(19) United States
(12) Patent Application Publication
(10) Pub. No.: US 2023/0165252 A1
(43) Pub. Date: Jun. 1, 2023

(54) ACTIVE COMPOUND COMBINATIONS

(71) Applicant: Bayer Aktiengesellschaft, Leverkusen (DE)

(72) Inventors: Agostinos Michael KLÜKEN, Krefeld (DE); Julie GEIST, Lyon (FR); Cyril MONTAGNE, Lyon (FR); Anthony MILLET, Tignieu-Jameyzieu (FR)

(73) Assignee: Bayer Aktiengesellschaft, Leverkusen (DE)

(21) Appl. No.: 17/927,624

(22) PCT Filed: May 26, 2021
(86) PCT No.: PCT/EP2021/063964

§ 371 Date: Nov. 23, 2022

(30) Foreign Application Priority Data
May 27, 2020 (EP) 20176911.4

(51) Int. Cl. A01N 43/58; A01N 25/30; A01P 3/00

(52) U.S. Cl. CPC A01N 43/58; A01N 25/30; A01P 3/00

(57) ABSTRACT

The present invention relates to active compound combinations, in particular within a fungicide composition, which comprise as compound (A) a compound of formula (I) and as compound (B) a further fungicidally active compound as specified below. Moreover, the invention relates to compositions comprising such compound combination and to the use of the compound combinations and the fungicide compositions as biologically active agent, especially for control of phytopathogenic fungi in crop protection and in the protection of industrial materials and as plant growth regulators.

The present invention relates to active compound combinations, in particular within a fungicide composition, which comprise as compound (A) a compound of formula (I) and as compound (B) a further fungicidally active compound as specified below. Moreover, the invention relates to compositions comprising such compound combination and to the use of the compound combinations and the fungicide compositions as biologically active agent, especially for control of phytopathogenic fungi in crop protection and in the protection of industrial materials and as plant growth regulators.

Throughout this application the terms “composition” and “formulation” are used synonymously and refer to mixtures of a compound combination of the invention and at least one agriculturally suitable auxiliary.

US 2009/0143355 discloses a 6-chloropyridazine-4-carboxamide as an intermediate in the preparation of substituted arylamine derivatives useful in treating cancer. In WO 2011/117254 pyridazine-4-carboxamides are published as potential modulators of Ghrelin receptor useful in treating diabetes and obesity. A 6-chloropyridazine-4-carboxamide as a component of a composition that may be used in the preparation of light-emitting devices in mentioned in US 2011/0108767.

Albeit compounds of formula (I) provide excellent means in protecting plants from diseases caused by fungi, there is still need to even improve those means in order to address the ever increasing environmental and economic requirements imposed on modern-day crop protection agents and compositions. This includes, for example, improvement to the spectrum of action, safety profile, selectivity, application rate, formation of residues, and favourable preparation ability, and development of new compositions to deal with potential problems, like resistances.

The present invention provides active compound combinations and compositions comprising said combinations which at least in some aspects achieve the stated objective.

Accordingly, the present invention provides active compound combinations comprising

(A) at least one compound of formula (I)

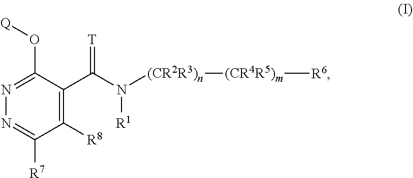

wherein
T is O or S;
n is 0 or 1;
m is 0 or 1;
provided m is 1 when n is 1;
R¹ is selected from the group consisting of hydrogen, hydroxyl, cyano, C₁-C₆-alkyl, C₁-C₆-alkoxy, C₁-C₆-alkoxy-C₁-C₆-alkyl, —C(═O)R^{a1}, —C(═O)(OR^{a1}), —S(═O)R^{a1}, —S(═O)₂R^{a1}, —C(═O)N(R^{a2})₂ and S(═O)₂N(R^{a2})₂ with R^{a1} being selected from the group consisting of C₁-C₆-alkyl, C₁-C₆-haloalkyl, C₃-C₈-cycloalkyl, and C₂-C₆-alkenyl and R^{a2} being selected from the group consisting of hydrogen, C₁-C₆-alkyl, C₁-C₆-haloalkyl, C₃-C₈-cycloalkyl and C₂-C₆-alkenyl;
R² and R³ are independently selected from the group consisting of hydrogen, halogen, cyano, hydroxyl, carboxyl, C₁-C₆-alkyl, C₁-C₆-haloalkyl, C₁-C₆-alkoxy, C₁-C₆-alkoxycarbonyl and C₃-C₈-cycloalkyl, or R² and R³ form, together with the carbon atom to which they are attached to, a C₃-C₈-cycloalkyl or a non-aromatic 3- to 7-membered monocyclic heterocycle;
R⁴ and R⁵ are independently selected from the group consisting of hydrogen, halogen, cyano, hydroxyl, carboxyl, C₁-C₆-alkyl, C₁-C₆-haloalkyl, C₁-C₆-alkoxy, C₁-C₆-alkoxycarbonyl and C₃-C₈-cycloalkyl, or R⁴ and R⁵ form, together with the carbon atom to which they are attached to, a C₃-C₈-cycloalkyl or a non-aromatic 3- to 7-membered monocyclic heterocycle; or
R² and R⁴ form, together with the carbon atom to which they are attached to, a C₃-C₈-cycloalkyl or a non-aromatic 3- to 7-membered monocyclic heterocycle, and R³ and R⁵ are independently hydrogen or halogen; or
R² and R⁴ form together a covalent bond and R³ and R⁵ are independently hydrogen or C₁-C₆-alkyl;
R⁶ is selected from the group consisting of non-aromatic C₃-C₁₂-carbocycle, aromatic C₆-C₁₄-carbocycle, non-aromatic 3- to 14-membered heterocycle, aromatic 5- to 14-membered heterocycle, non-aromatic C₃-C₁₂-carbocyclyloxy, aromatic C₆-C₁₄-carbocyclyloxy, aromatic 5- to 14-membered heterocyclyloxy, non-aromatic 3- to 14-membered heterocyclyloxy, C₁-C₃-alkoxy substituted by a non-aromatic C₃-C₁₂-carbocycle, C₁-C₃-alkoxy substituted by an aromatic C₆-C₁₄-carbocycle, C₁-C₃-alkoxy substituted by a non-aromatic 3- to 14-membered heterocycle, C₁-C₃-alkoxy substituted by an aromatic 5- to 14-membered heterocycle, C₁-C₃-haloalkoxy substituted by a non-aromatic C₃-C₁₂-carbocycle, C₁-C₃-haloalkoxy substituted by an aromatic C₆-C₁₄-carbocycle, C₁-C₃-haloalkoxy substituted by a non-aromatic 3- to 14-membered heterocycle and C₁-C₃-haloalkoxy substituted by an aromatic 5- to 14-membered heterocycle, wherein cyclic, or cyclic moiety of, R⁶ substituents may be substituted with one or more R^{6S} substituents that may be the same or different,
   R^{6S} is selected from the group consisting of halogen, cyano, isocyano, nitro, hydroxyl, mercapto, pentafluorosulfanyl, oxo, methylidene, halomethylidene, C₁-C₆-alkyl, C₁-C₆-haloalkyl, C₁-C₆-alkoxy, C₁-C₆-haloalkoxy, C₂-C₆-alkenyl, C₂-C₆-haloalkenyl, C₂-C₆-alkynyl, C₂-C₆-haloalkynyl, C₂-C₆-alkenyloxy, C₂-C₆-haloalkenyloxy, C₁-C₆-alkylsulfanyl, C₁-C₆-haloalkylsulfanyl, C₃-C₈-cycloalkylsulfanyl, C₁-C₆-alkylsulfinyl, C₁-C₆-haloalkylsulfinyl, C₃-C₈-cycloalkylsulfinyl, C₁-C₆-alkylsulfonyl, C₁-C₆-haloalkylsulfonyl, C₃-C₈-cycloalkylsulfonyl, C₃-C₈-cycloalkyl, C₃-C₈-cycloalkyloxy, C₃-C₈-cycloalkenyl, aromatic C₆-C₁₄-carbocycle, aromatic 5- or 6-membered monocyclic heterocycle, non-aromatic 3- to 7-membered monocyclic heterocycle, —N(R^{c})₂, —C(═O)R^{d}, —C(═O)(OR^{d}), —C(═O)N(R^{d})₂, —S(═O)₂N(R^{d})₂, —O—Si(C₁-C₆-alkyl)₃ and —Si(C₁-C₆-alkyl)₃, or two R^{6S} substituents may form, together with the carbon atom to which they are attached to, a C₃-C₈-cycloalkyl,
      with R^{c} being independently selected from the group consisting of hydrogen, C₁-C₆-alkyl and C₃-C₈-cycloalkyl,
      with R^{d} being independently selected from the group consisting of hydrogen, C₁-C₆-alkyl and C₁-C₆-haloalkyl,
   wherein aliphatic R^{6S}, R^{c} and R^{d} substituents may be substituted with one or more substituents independently selected from the group consisting of cyano, hydroxyl, C₁-C₆-alkoxy, C₁-C₆-haloalkoxy, —O—Si(C₁-C₆-alkyl)₃, —Si(C₁-C₆-alkyl)₃, C₃-C₈-cycloalkyl, C₃-C₈-halocycloalkyl and non-aromatic 3- to 7-membered monocyclic heterocycle,
   wherein cyclic or cyclic moiety of R^{6S} and cyclic R^{c} substituents may be substituted with one or more substituents independently selected from the group consisting of halogen, cyano, nitro, hydroxyl, formyl, carboxyl, oxo, methylidene, halomethylidene, C₁-C₆-alkyl, C₁-C₆-haloalkyl, C₁-C₆-alkoxy, C₁-C₆-haloalkoxy, C₁-C₆-alkoxycarbonyl, C₁-C₆-haloalkoxycarbonyl, C₂-C₆ alkenyl, C₃-C₈-cycloalkyl and C₃-C₈-halocycloalkyl, and/or cyclic or cyclic moiety of R^{6S} substituents may be substituted with two substituents forming, together with the carbon atom to which they are attached to, a C₃-C₈-cycloalkyl;
R⁷ is selected from the group consisting of hydrogen, halogen, cyano, isocyano, hydroxyl, mercapto, nitro, amino, formyl, C₁-C₆-alkyl, C₁-C₆-haloalkyl, C₁-C₆-hydroxyalkyl, C₁-C₆-alkylcarbonyl, C₁-C₆-haloalkylcarbonyl, C₁-C₆-alkoxy, C₁-C₆-haloalkoxy, C₂-C₆-alkenyl, C₂-C₆-haloalkenyl, C₂-C₆-alkynyl, C₂-C₆-haloalkynyl, C₂-C₆-alkenyloxy, C₂-C₆-haloalkenyloxy, C₂-C₆-alkynyloxy, C₂-C₆-haloalkynyloxy, C₁-C₆-alkylsulfanyl, C₁-C₆-haloalkylsulfanyl, C₃-C₈-cycloalkylsulfanyl, C₁-C₆-alkylsulfinyl, C₁-C₆-haloalkylsulfinyl, C₃-C₈-cycloalkylsulfinyl, C₁-C₆-alkylsulfonyl, C₁-C₆-haloalkylsulfonyl, C₃-C₈-cycloalkylsulfonyl, C₃-C₈-cycloalkyl, C₃-C₆-cycloalkenyl, aromatic C₆-C₁₄-carbocycle, aromatic 5- or 6-membered monocyclic heterocycle, non-aromatic 3- to 7-membered monocyclic heterocycle, C₃-C₈-cycloalkyloxy, aromatic C₆-C₁₄-carbocyclyloxy, aromatic 5- or 6-membered monocyclic heterocyclyloxy, non-aromatic 3- to 7-membered monocyclic heterocyclyloxy, —O—Si(C₁-C₆-alkyl)₃, —Si(C₁-C₆-alkyl)₃, —N(R^{e})₂, —C(═NR^{f})R^{f}, —NR^{g}C(═O)R^{g}, —C(═O)(OR^{g}), —C(═O)N(R^{g})₂, —S(═O)₂N(R^{g})₂ and —S(═O)(═NR^{g})R^{g},
with R^{e} being independently selected from the group consisting of hydrogen, C₁-C₆-alkyl, C₁-C₆-haloalkyl, C₁-C₆-alkoxy, C₂-C₆-alkenyl, C₂-C₆-haloalkenyl, C₂-C₆-alkynyl, C₂-C₆-haloalkynyl, C₃-C₈-cycloalkyl, C₃-C₈-halocycloalkyl, aromatic C₆-C₁₄-carbocycle, aromatic 5- or 6-membered monocyclic heterocycle and non-aromatic 3- to 7-membered monocyclic heterocycle,
with R^{f} being independently selected from the group consisting of hydroxyl, amino, cyano, C₁-C₆-alkyl, C₁-C₆-haloalkyl, C₁-C₆-alkoxy, C₁-C₆-alkylamino and di(C₁-C₆-alkyl)amino,
with R^{g} being independently selected from the group consisting of hydrogen, C₁-C₆-alkyl, C₁-C₆-haloalkyl and C₃-C₈-cycloalkyl,
   wherein aliphatic R⁷, R^{e}, R^{f} and R^{g} substituents may be substituted with one or more R^{7Sa} substituents that may be the same or different,
   wherein cyclic or cyclic moiety of R⁷, cyclic R^{e} and cyclic R^{g} substituents may be substituted with one or more R^{7Sc} substituents that may be the same or different,
R^{7Sa} is selected from the group consisting of cyano, hydroxyl, carboxyl, C₁-C₆-alkoxy, C₁-C₆-haloalkoxy, C₃-C₈-cycloalkyl, C₃-C₈-halocycloalkyl, C₁-C₆-alkoxycarbonyl, —O—Si(C₁-C₆-alkyl)₃, —Si(C₁-C₆-alkyl)₃, aromatic C₆-C₁₄-carbocycle and non-aromatic 3- to 7-membered monocyclic heterocycle,
R^{7Sc} is selected from the group consisting of halogen, cyano, nitro, hydroxyl, formyl, oxo, methylidene, halomethylidene, C₁-C₆-alkyl, C₁-C₆-haloalkyl C₁-C₆-alkoxy, C₁-C₆-haloalkoxy, C₂-C₆ alkenyl, C₃-C₈-cycloalkyl, C₃-C₈-halocycloalkyl, —O—Si(C₁-C₆-alkyl)₃ and non-aromatic 3- to 7-membered monocyclic heterocycle, or two R^{7Sc} substituents form, together with the carbon atom to which they are attached to, a C₃-C₈-cycloalkyl;
R⁸ is selected from the group consisting of hydrogen, halogen, cyano, isocyano, amino, nitro, hydroxyl, mercapto, carboxyl, C₁-C₆-alkoxycarbonyl, C₁-C₆-alkyl, C₁-C₆-haloalkyl, C₁-C₆-hydroxyalkyl, C₁-C₆-alkoxy, C₁-C₆-haloalkoxy, C₂-C₆-alkenyl, C₂-C₆-haloalkenyl, C₂-C₆-alkynyl, C₂-C₆-haloalkynyl, C₂-C₆-alkenyloxy, C₂-C₆-haloalkenyloxy, C₂-C₆-alkynyloxy, C₂-C₆-haloalkynyloxy, C₁-C₆-alkylsulfanyl, C₁-C₆-haloalkylsulfanyl, C₁-C₆-alkylsulfinyl, C₁-C₆-haloalkylsulfinyl, C₁-C₆-alkylsulfonyl, C₁-C₆-haloalkylsulfonyl, C₃-C₈-cycloalkyl, C₃-C₆-cycloalkenyl, aromatic C₆-C₁₄-carbocycle, non-aromatic 3- to 14-membered heterocycle, aromatic 5- to 14-membered heterocycle, C₃-C₈-cycloalkyloxy, aromatic C₆-C₁₄-carbocyclyloxy, non-aromatic 3- to 14-membered heterocyclyloxy, aromatic 5- to 14-membered heterocyclyloxy, —O—Si(C₁-C₆-alkyl)₃, —Si(C₁-C₆-alkyl)₃, —N(R^{h})₂, —SRⁱ, —S(═O)Rⁱ and —S(═O)₂Rⁱ,
with R^{h} being independently selected from the group consisting of hydrogen, C₁-C₆-alkyl, C₁-C₆-haloalkyl, C₁-C₆-alkoxy, C₂-C₆ alkenyl, C₂-C₆haloalkenyl, C₂-C₆-alkynyl, C₂-C₆-haloalkynyl, C₃-C₈-cycloalkyl, C₃-C₈-halocycloalkyl, aromatic C₆-C₁₄-carbocycle, aromatic 5- to 14-membered heterocycle and non-aromatic 3- to 7-membered monocyclic heterocycle,
with Rⁱ being selected from the group consisting of C₂-C₆ alkenyl, C₂-C₆haloalkenyl, C₂-C₆-alkynyl, C₂-C₆-haloalkynyl, C₃-C₈-cycloalkyl, C₃-C₈-halocycloalkyl, aromatic C₆-C₁₄-carbocycle, aromatic 5- to 14-membered heterocycle and non-aromatic 3- to 7-membered monocyclic heterocycle,
   wherein aliphatic R⁸, R^{h} and Rⁱ substituents may be substituted with one or more R^{8Sa} substituents that may be the same or different,
   wherein cyclic or cyclic moiety of R⁸, cyclic R^{h} and cyclic Rⁱ substituents may be substituted with one or more R^{8Sc} substituents that may be the same or different,
R^{8Sa} is selected from the group consisting of cyano, amino, nitro, hydroxyl, formyl, carboxyl, C₁-C₆-alkoxy, C₁-C₆-haloalkoxy, C₁-C₆-alkoxy-C₁-C₆-alkoxy, C₁-C₆-alkoxycarbonyl, C₁-C₆-haloalkoxycarbonyl, C₁-C₆-alkylcarbonyl, C₁-C₆-haloalkylcarbonyl, C₃-C₈-cycloalkyl, C₃-C₈-halocycloalkyl, C₁-C₆-alkylsulfanyl, C₁-C₆-haloalkylsulfanyl, C₁-C₆-alkylsulfinyl, C₁-C₆-haloalkylsulfinyl, C₁-C₆-alkylsulfonyl, C₁-C₆-haloalkylsulfonyl, —O—Si(C₁-C₆-alkyl)₃, —Si(C₁-C₆-alkyl)₃, non-aromatic 3- to 7-membered monocyclic heterocycle and —N(R^{a′})₂ with R^{a′} being independently selected from the group consisting of hydrogen, formyl, C₁-C₆-alkyl, C₁-C₆-haloalkyl, C₃-C₈-cycloalkyl and C₁-C₆-alkylcarbonyl, wherein said non-aromatic 3- to 7-membered monocyclic heterocycle R^{8Sa} may be substituted with one or more C₁-C₆-alkyl substituents that may be the same or different,
R^{8Sc} is selected from the group consisting of halogen, cyano, amino, nitro, hydroxyl, formyl, carboxyl, oxo, methylidene, halomethylidene, C₁-C₆-alkyl, C₁-C₆-haloalkyl, C₁-C₆-alkoxy, C₁-C₆-haloalkoxy, C₁-C₆-alkoxycarbonyl, C₁-C₆-haloalkoxycarbonyl, C₂-C₆ alkenyl, C₁-C₆-alkylsulfanyl, C₁-C₆-alkylsulfinyl, C₁-C₆-alkylsulfonyl, C₃-C₈-cycloalkyl, C₃-C₈-halocycloalkyl, —O—Si(C₁-C₆-alkyl)₃ and non-aromatic 3- to 7-membered monocyclic heterocycle that may be substituted with one or more C₁-C₆-alkyl substituents that may be the same or different, or two R^{8Sc} substituents form, together with the carbon atom to which they are attached to, a C₃-C₈-cycloalkyl or a non-aromatic 3- to 7-membered monocyclic heterocycle, wherein said non-aromatic 3- to 7-membered monocyclic heterocycle may be substituted with one or more C₁-C₆-alkyl substituents that may be the same or different;
Q is selected from the group consisting of aromatic C₆-C₁₄-carbocycle, non-aromatic C₃-C₁₂-carbocycle, non-aromatic 3- to 14-membered heterocycle and aromatic 5- to 14-membered heterocycle, wherein any of said carbocycle or heterocycle groups may be substituted with one or more Q^{S} substituents that may be the same or different,
   Q^{S} is selected from the group consisting of halogen, cyano, isocyano, nitro, hydroxyl, mercapto, formyl, carboxyl, C₁-C₆-alkyl, C₁-C₆-haloalkyl, C₁-C₆-alkylcarbonyl, C₁-C₆-haloalkylcarbonyl, C₁-C₆-alkoxy, C₁-C₆-haloalkoxy, C₁-C₆-alkoxy-C₁-C₆-alkyl, C₁-C₆-alkoxycarbonyl, C₁-C₆-haloalkoxycarbonyl, C₂-C₆ alkenyl, C₂-C₆haloalkenyl, C₂-C₆-alkynyl, C₂-C₆-haloalkynyl, C₂-C₆-alkenyloxy, C₂-C₆-haloalkenyloxy, C₁-C₆-alkylsulfanyl, C₁-C₆-haloalkylsulfanyl, C₁-C₆-alkylsulfinyl, C₁-C₆-haloalkylsulfinyl, C₁-C₆-alkylsulfonyl, C₁-C₆-haloalkylsulfonyl, C₃-C₈-cycloalkyl, C₃-C₈-cycloalkyloxy, C₃-C₆-cycloalkenyl, non-aromatic 3- to 7-membered monocyclic heterocycle, aromatic 5- to 14-membered heterocycle, —O—Si(C₁-C₆-alkyl)₃, —Si(C₁-C₆-alkyl)₃, —O—C(═O)R^{j}, —NR^{j}C(═O)R^{j}, —C(═O)N(R^{j})₂, —C(═S)R^{j}, —C(═S)N(R^{j})₂, —C(═NR^{j})R^{j} and —C(═NOR^{j})R^{j} and —N(R^{k})₂
      with R^{j} being independently selected from the group consisting of hydrogen, C₁-C₆-alkyl, C₁-C₆-haloalkyl and C₁-C₆-alkoxy,
      with R^{k} being independently selected from the group consisting of hydrogen, hydroxyl, C₁-C₆-alkyl, C₁-C₆-haloalkyl, C₁-C₆-alkoxy, C₂-C₆ alkenyl, C₂-C₆haloalkenyl and C₃-C₈-cycloalkyl,
   wherein aliphatic Q^{S}, R^{j} and R^{k} substituents may be substituted with one or more substituents independently selected from the group consisting of cyano, amino, nitro, hydroxyl, C₁-C₆-alkoxy, C₁-C₆-haloalkoxy, C₁-C₆-alkoxycarbonyl, C₁-C₆-haloalkoxycarbonyl, C₃-C₈-cycloalkyl, C₃-C₈-halocycloalkyl, —Si(C₁-C₆-alkyl)₃ and non-aromatic 3- to 7-membered monocyclic heterocycle,
   wherein cyclic or cyclic moiety of Q^{S} and cyclic R^{k} substituents may be substituted with one or more R^{Qs} substituents independently selected from the group consisting of halogen, cyano, amino, nitro, hydroxyl, formyl, carboxyl, oxo, methylidene, halomethylidene, C₁-C₆-alkyl, C₁-C₆-haloalkyl, C₁-C₆-alkoxy, C₁-C₆-haloalkoxy, C₁-C₆-alkoxycarbonyl, C₁-C₆-haloalkoxycarbonyl, C₃-C₈-cycloalkyl, C₃-C₈-halocycloalkyl, C₂-C₆ alkenyl and non-aromatic 3- to 7-membered monocyclic heterocycle, wherein cyclic R^{Qs} substituents may be substituted with two substituents forming, together with the carbon atom to which they are attached to, a C₃-C₈-cycloalkyl,
      provided that compound of formula (I) is not:
(a) 3-(1H-benzotriazol-1-yloxy)-N-(4-tert-butylphenyl)-6-chloropyridazine-4-carboxamide ([561297-99-2]);
(b) 3-(cyclopentyloxy)-6-(4-fluorophenoxy)-N-{[(3R)-1-isopropylpiperidin-3-yl]methyl}pyridazine-4-carboxamide ([1336909-91-1]);
(c) 6-(4-fluorophenoxy)-N-{[(3R)-1-isopropylpiperidin-3-yl]methyl}-3-(tetrahydro-2H-pyran-4-yloxy)pyridazine-4-carboxamide ([1336909-90-0]);
(d) 6-chloro-N-{[(3R)-1-isopropylpiperidin-3-yl]methyl}-3-(tetrahydro-2H-pyran-4-yloxy)pyridazine-4-carboxamide ([1336910-48-5]);
(e) 6-chloro-3-(cyclopentyloxy)-N-{[(3R)-1-isopropylpiperidin-3-yl]methyl}pyridazine-4-carboxamide ([1336910-49-6]);
(f) 3-(1H-benzotriazol-1-yloxy)-6-chloro-N-(cyclohexylmethyl)pyridazine-4-carboxamide ([1202404-84-9)],
and

(B) at least one further active compound selected from
(1) inhibitors of the ergosterol synthesis,
(2) inhibitors of the respiratory chain at complex I or II,
(3) inhibitors of the respiratory chain at complex III,
(4) inhibitors of the mitosis and cell division,
(5) compounds capable of having a multisite action,
(6) compounds capable of inducing a host defense,
(7) inhibitors of the amino acid and/or protein biosynthesis,
(8) inhibitors of the ATP production,
(9) inhibitors of the cell wall synthesis,
(10) inhibitors of the lipid and membrane synthesis,
(11) inhibitors of the melanine biosynthesis,
(12) inhibitors of the nucleic acid synthesis,
(13) inhibitors of the signal transduction,
(14) compounds capable of acting as uncoupler,
(15) other fungicides,
(16) antibacterial agents
(17) biological fungicides
(18) fatty acids or derivatives thereof.

Compound (A)

The active compound combinations according to the invention comprise as compound (A) at least one compound of formula (I) or a salt or N-oxide thereof.

In a more preferred embodiment compounds according to the present invention are compounds of formula (I), wherein
T is O;
n is 0 or 1;
m is 0 or 1;
provided m is 1 when n is 1;
R¹ is selected from the group consisting of hydrogen, hydroxyl, C₁—C-alkyl and —C(═O)(OR^{a1}), with R^{a1} being selected from the group consisting of C₁-C₄-alkyl and C₂-C₄-alkenyl,
R² and R³ are hydrogen, or R² and R³ form, together with the carbon atom to which they are attached to, a C₃-C₆-cycloalkyl,
R⁴ and R⁵ are independently selected from the group consisting of hydrogen, fluorine, chlorine and C₁-C₄-alkyl, or R⁴ and R⁵ form, together with the carbon atom to which they are attached to, a C₃-C₆-cycloalkyl; or
R² and R⁴ form, together with the carbon atom to which they are attached to, a C₃-C₆-cycloalkyl, and R³ and R⁵ are independently hydrogen or halogen; or
R⁶ is selected from the group consisting of an indanyl, a 1,2,3,4-tetrahydronaphthalenyl, a spiro[cyclopropane-1,2′-indane]-1-yl, phenyl, naphthyl, a 4- to 6-membered monocyclic non-aromatic heterocycle fused to a phenyl, a 5- or 6-membered monocyclic heteroaryl fused to a monocyclic C₃-C₈-cycloalkyl, an aromatic 5- or 6-membered monocyclic heterocycle, a 5- or 6-membered monocyclic aromatic heterocycle fused to an aryl, phenoxy, benzyloxy or —OCF₂-phenyl, wherein cyclic, or cyclic moiety of, R⁶ substituents may be substituted by one to three R^{6S} substituents selected from the group consisting of fluorine, chlorine, cyano, C₁-C₄ alkyl, C₁-C₄ haloalkyl, C₁-C₄-alkoxy, C₁-C₄-haloalkoxy, C₂-C₆-alkenyl, C₂-C₆-alkynyl, C₁-C₄-haloalkylsulfanyl, C₃-C₆-cycloalkyl, phenyl, pyridyl, pyrazolyl, imidazolyl, triazolyl, oxetanyl and tetrahydrofuranyl,
   wherein cyclic or cyclic moiety of R^{6S} substituents may be substituted with one to three substituents independently selected from the group consisting of fluorine, chlorine, C₁-C₄-alkyl, C₁-C₄-haloalkyl and C₁-C₄-alkoxycarbonyl,
R⁷ is selected from the group consisting of hydrogen, chlorine, C₁-C₄-alkyl, C₁-C₄ haloalkyl, C₁-C₄-hydroxyalkyl, C₁-C₄-alkylcarbonyl, C₁-C₄-alkoxy, C₂-C₆-alkenyl, C₂-C₆-alkynyl, C₃-C₆-cycloalkyl, pyridinyl, imidazolyl, pyrazolyl, oxetanyl, tetrahydrofuranyl, tetrahydropyranyl, pyrrolidinyl, azetidinyl and —N(R^{e})₂,
with R^{e} being independently selected from the group consisting of hydrogen, C₁-C₄-alkyl and C₃-C₆-cycloalkyl,
   wherein aliphatic R⁷ and R^{e} substituents may be substituted with one or two R^{7Sa} substituents independently selected from the group consisting of C₁-C₄-alkoxy, C₃-C₆-cycloalkyl, C₁-C₂-alkoxycarbonyl and phenyl,
   wherein cyclic or cyclic moiety of R⁷ and cyclic R^{e} may be substituted with one or two R^{7Se} substituents independently selected from the group consisting of fluorine, chlorine, hydroxyl, C₁-C₄-alkyl and C₁-C₄-alkoxy,
R⁸ is selected from the group consisting of hydrogen, halogen, hydroxyl, C₁-C₄-alkyl, C₁-C₄-haloalkyl, C₁-C₄-alkoxy, C₂-C₆-alkenyl, C₂-C₆-alkenyloxy, C₂-C₆-haloalkenyloxy, C₁-C₄-alkylsulfanyl, C₁-C₄-haloalkylsulfanyl, C₁-C₄ alkylsulfinyl, C₁-C₄-alkylsulfonyl, C₃-C₆-cycloalkyl, phenyl, non-aromatic 3- to 7-membered heterocycle, aromatic 5- or 6-membered heterocycle, non-aromatic 3- to 7-membered heterocyclyloxy and —N(R^{h})₂,
with R^{h} being independently selected from the group consisting of hydrogen, C₁-C₄-alkyl, C₂-C₆ alkenyl, C₃-C₆-cycloalkyl, phenyl and non-aromatic 3- to 7-membered monocyclic heterocycle,
   wherein aliphatic R⁸ and R^{h} substituents may be substituted with one to three R^{8Sa} substituents independently selected from the group consisting of hydroxyl, carboxyl, C₁-C₄-alkoxy, C₁-C₄ alkoxy C₁-C₄-alkoxy, C₁-C₄-alkoxycarbonyl, C₃-C₆-cycloalkyl, non-aromatic 3- to 7-membered monocyclic heterocycle and —N(R^{a′})₂ with R^{a′} being independently selected from the group consisting of hydrogen, C₁-C₄-alkyl and C₁-C₂-alkylcarbonyl,
   wherein cyclic or cyclic moiety of R⁸ and cyclic R^{h} substituents may be substituted with one to three R^{8Sc} substituents independently selected from the group consisting of chlorine, cyano, hydroxyl, C₁-C₄-alkyl, C₁-C₄ haloalkyl, C₁-C₄-alkoxy, C₁-C₄-alkoxycarbonyl, C₃-C₆-cycloalkyl, oxolanyl, oxetanyl and tetrahydrofuranyl, or two R^{8Sc} substituents form, together with the carbon atom to which they are attached to a oxetanyl or oxiranyl,
Q is selected from the group consisting of phenyl, naphth-2-yl, bicyclo[4.2.0]octa-1(6), 2,4-trienyl, indanyl, 1,2,3,4-tetrahydronaphthalenyl, indenyl, dihydronaphthalenyl, bicyclo[4.2.0]octa-1(6),2,4-trienyl, 2,3-dihydrobenzofuranyl, 1,3-dihydroisobenzofuranyl, indolinyl, 1,3-benzodioxolyl, chromanyl, 2,3-dihydro-1,4-benzodioxinyl, [1,3]dioxolo[4,5-b]pyridinyl, 5,6,7,8-tetrahydroquinolinyl, 6,7-dihydro-5H-cyclopenta[b]pyridinyl, 1,3-benzodioxolyl, 2,3-dihydrobenzofuranyl, pyrrolyl, furanyl, thienyl, imidazolyl, triazolyl, oxazolyl, thiazolyl, pyridinyl, pyridazinyl and pyrimidinyl, indolyl, benzimadozolyl, indazolyl, benzofuranyl, benzothiophenyl, benzothiazolyl, benzoxazolyl, quinolinyl, furo[3,2-b]pyridinyl, thieno[3,2-b]thiophenyl and thieno[2,3-d]thiazolyl,
   wherein any of said carbocycle or heterocycle groups may be substituted with one to three Q^{S} substituents independently selected from the group consisting of halogen, C₁-C₄-alkyl, C₁-C₄ haloalkyl, C₁-C₄-alkoxy, C₁-C₄-haloalkoxy, C₂-C₄ alkenyl, C₂-C₄-alkynyl, C₁-C₄-alkylsulfanyl, C₁-C₄-haloalkylsulfanyl, C₃-C₆-cycloalkyl, oxiranyl, oxetanyl and —N(R^{k})₂
with R^{k} being hydrogen,
wherein cyclic or cyclic moiety of Q^{S} substituents may be substituted with one or two R^{Qs} substituents independently selected from the group consisting of fluorine and chlorine.

In a even more preferred embodiment compounds according to the present invention are compounds of formula (I), wherein

T is O

R¹ is hydrogen,

R² and R³, when present (i.e. n=1), are hydrogen, or R² and R³ form, together with the carbon atom to which they are attached to, a cyclopropyl or cyclobutyl,

R⁴ and R⁵, when present (i.e. m=1), are independently selected from the group consisting of hydrogen and halogen,

R⁶ is indanyl, 1,2,3,4-tetrahydronaphthalenyl, spiro[cyclopropane-1,2′-indane]-1-yl, phenyl, 2,3-dihydrobenzofuranyl, 1,3-benzodioxolyl, 2,3-dihydro-1,4-benzodioxinyl, 4,5,6,7-tetrahydrobenzothiophenyl, thienyl, pyridinyl indolyl, benzoxazolyl, quinolinyl or isoquinolinyl,
wherein said indanyl, a 1,2,3,4-tetrahydronaphthalenyl, spiro[cyclopropane-1,2′-indane]-1-yl, phenyl, 2,3-dihydrobenzofuranyl, 1,3-benzodioxolyl, 2,3-dihydro-1,4-benzodioxinyl, 4,5,6,7-tetrahydrobenzothiophenyl, thienyl, pyridinyl, indolyl, benzoxazolyl, quinolinyl or isoquinolinyl may be substituted by one to three R^{6S} substituents independently selected from the group consisting of halogen, cyano, C₁-C₆-alkyl, C₁-C₆-haloalkyl, C₁-C₆-alkoxy, C₁-C₆-haloalkoxy, C₂-C₆-alkenyl, C₂-C₆-alkynyl, cyclopropyl,

R⁷ is hydrogen, halogen, cyano, C₁-C₄ alkyl, C₁-C₄ haloalkyl, C₁-C₄-hydroxyalkyl, C₁-C₄-alkylcarbonyl, C₁-C₄-alkoxy, C₂-C₆-alkenyl, C₂-C₆-alkynyl or cyclopropyl,
wherein aliphatic R⁷ may be substituted by one or two R^{7Sa} substituents methoxy

R⁸ is hydrogen, halogen, C₁-C₄-alkyl, C₁-C₄-alkoxy, C₂-C₄-alkenyl, C₁-C₄-alkylsulfanyl, pyrazolyl, imidazolyl, thiazolyl, pyridinyl or —N(R^{h})₂,
wherein R^{h} is independently selected from the group consisting of hydrogen, C₁-C₄-alkyl and cyclopropyl,
wherein said aliphatic R⁸ substituents may be substituted by one or two R^{8Sa} substituents independently selected from the group consisting of C₁-C₄-haloalkyl, C₁-C₄-alkoxy, C₁-C₄-alkoxy-C₁-C₂-alkoxy, cyclopropyl and cyclobutyl,
wherein said cyclic R⁸ substituents may be substituted by one or two R^{8Sc} substituents independently selected from the group consisting of halogen,

Q is phenyl, thienyl or pyridinyl,
wherein said phenyl, thienyl and pyridinyl may be substituted by one to three Q^{S} substituents independently selected from the group consisting of halogen, C₁-C₄-alkyl, C₁-C₄ haloalkyl, C₁-C₄-alkoxy, C₁-C₄-haloalkoxy, C₂-C₄ alkenyl, C₂-C₄-alkynyl, C₁-C₄-alkylsulfanyl, C₁-C₄-haloalkylsulfanyl, cyclopropyl, cyclobutyl, oxiranyl and oxetanyl.

More preferred compound combinations according to the invention comprise (A) a compound of formula (I) selected from the group consisting of (I-655) 6-chloro-3-(3-cyclopropyl-2-fluorophenoxy)-N-[2-(2,4-dimethylphenyl)-2,2-difluoroethyl]-5-methylpyridazine-4-carboxamide, (I-667) 3-(3-bromo-2-fluoro-phenoxy)-6-chloro-N-[2-(2-chloro-4-methylphenyl)-2,2-difluoroethyl]-5-methylpyridazine-4-carboxamide, (I-746) 6-chloro-N-[2-(2-chloro-4-methylphenyl)-2,2-difluoroethyl]-3-(3-cyclopropyl-2-fluoro-phenoxy)-5-methylpyridazine-4-carboxamide, (I-749) 6-chloro-3-(3-cyclopropyl-2-fluorophenoxy)-N-[2-(3,4-dimethylphenyl)-2,2-difluoroethyl]-5-methylpyridazine-4-carboxamide, (I-784) 6-chloro-3-(3-chloro-2-fluorophenoxy)-N-[2-(2,4-dimethylphenyl)-2,2-difluoroethyl]-5-methylpyridazine-4-carboxamide, (I-840) N-[2-(2-bromo-4-methylphenyl)-2,2-difluoroethyl]-6-chloro-3-(3-cyclopropyl-2-fluoro-phenoxy)-5-methylpyridazine-4-carboxamide.

Even more preferred compound combinations according to the invention comprise (A) a compound of formula (I) selected from the group consisting of (I-655) 6-chloro-3-(3-cyclopropyl-2-fluorophenoxy)-N-[2-(2,4-dimethylphenyl)-2,2-difluoroethyl]-5-methylpyridazine-4-carboxamide, (I-746) 6-chloro-N-[2-(2-chloro-4-methylphenyl)-2,2-difluoroethyl]-3-(3-cyclopropyl-2-fluorophenoxy)-5-methylpyridazine-4-carboxamide, (I-749) 6-chloro-3-(3-cyclopropyl-2-fluorophenoxy)-N-[2-(3,4-dimethylphenyl)-2,2-difluoroethyl]-5-methylpyridazine-4-carboxamide.

### Definitions

The term “halogen” as used herein refers to fluorine, chlorine, bromine or iodine atom.

The term “methylidene” as used herein refers to a CH₂ group connected to a carbon atom via a double bond.

The term “halomethylidene” as used herein refers to a CX₂ group connected to a carbon atom via a double bond, wherein X is halogen.

The term “oxo” as used herein refers to an oxygen atom which is bound to a carbon atom or sulfur atom via a double bound.

The term “C₁-C₆-alkyl” as used herein refers to a saturated, branched or straight hydrocarbon chain having 1, 2, 3, 4, 5 or 6 carbon atoms. Examples of C₁-C₆-alkyl include but are not limited to methyl, ethyl, propyl (n-propyl), 1-methylethyl (iso-propyl), butyl (n-butyl), 1-methylpropyl (sec-butyl), 2-methylpropyl (iso-butyl), 1,1-dimethylethyl (tert-butyl), pentyl, 1-methylbutyl, 2-methylbutyl, 3-methylbutyl, 2,2-dimethylpropyl, 1-ethylpropyl, 1,1-dimethylpropyl, 1,2-dimethylpropyl, hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl and 1-ethyl-2-methylpropyl. Particularly, said hydrocarbon chain has 1, 2, 3 or 4 carbon atoms (“C₁-C₄-alkyl”), e.g. methyl, ethyl, propyl, iso-propyl, butyl, sec-butyl, iso-butyl or tert-butyl.

The term “C₂-C₆-alkenyl” as used herein refers to an unsaturated, branched or straight hydrocarbon chain having 2, 3, 4, 5 or 6 carbon atoms and comprising at least one double bond. Examples of C₂-C₆-alkenyl include but are not limited to ethenyl (or “vinyl”), prop-2-en-1-yl (or “allyl”), prop-1-en-1-yl, but-3-enyl, but-2-enyl, but-1-enyl, pent-4-enyl, pent-3-enyl, pent-2-enyl, pent-1-enyl, hex-5-enyl, hex-4-enyl, hex-3-enyl, hex-2-enyl, hex-1-enyl, prop-1-en-2-yl (or “isopropenyl”), 2-methylprop-2-enyl, 1-methylprop-2-enyl, 2-methylprop-1-enyl, 1-methylprop-1-enyl, 3-methylbut-3-enyl, 2-methylbut-3-enyl, 1-methylbut-3-enyl, 3-methylbut-2-enyl, 2-methylbut-2-enyl, 1-methylbut-2-enyl, 3-methylbut-1-enyl, 2-methylbut-1-enyl, 1-methylbut-1-enyl, 1,1-dimethylprop-2-enyl, 1-ethylprop-1-enyl, 1-propylvinyl, 1-isopropylvinyl, 4-methylpent-4-enyl, 3-methylpent-4-enyl, 2-methylpent-4-enyl, 1-methylpent-4-enyl, 4-methylpent-3-enyl, 3-methylpent-3-enyl, 2-methylpent-3-enyl, 1-methylpent-3-enyl, 4-methylpent-2-enyl, 3-methylpent-2-enyl, 2-methylpent-2-enyl, 1-methylpent-2-enyl, 4-methylpent-1-enyl, 3-methylpent-1-enyl, 2-methylpent-1-enyl, 1-methylpent-1-enyl, 3-ethylbut-3-enyl, 2-ethylbut-3-enyl, 1-ethylbut-3-enyl, 3-ethylbut-2-enyl, 2-ethylbut-2-enyl, 1-ethylbut-2-enyl, 3-ethylbut-1-enyl, 2-ethylbut-1-enyl, 1-ethylbut-1-enyl, 2-propylprop-2-enyl, 1-propylprop-2-enyl, 2-isopropylprop-2-enyl, 1-isopropylprop-2-enyl, 2-propylprop-1-enyl, 1-propylprop-1-enyl, 2-isopropylprop-1-enyl, 1-isopropylprop-1-enyl, 3,3-dimethyl-prop-1-enyl, 1-(1,1-dimethylethyl)ethenyl, buta-1,3-dienyl, penta-1,4-dienyl, hexa-1,5-dienyl or methylhexadienyl group.

The term “C₂-C₆-alkynyl” as used herein refers to a branched or straight hydrocarbon chain having 2, 3, 4, 5 or 6 carbon atoms and comprising at least one triple bond. Examples of C₂-C₆-alkynyl include but are not limited to ethynyl, prop-1-ynyl, prop-2-ynyl (or “propargyl”), but-1-ynyl, but-2-ynyl, but-3-ynyl, pent-1-ynyl, pent-2-ynyl, pent-3-ynyl, pent-4-ynyl, hex-1-ynyl, hex-2-ynyl, hex-3-ynyl, hex-4-ynyl, hex-5-ynyl, 1-methylprop-2-ynyl, 2-methylbut-3-ynyl, 1-methylbut-3-ynyl, 1-methylbut-2-ynyl, 3-methylbut-1-ynyl, 1-ethylprop-2-ynyl, 3-methylpent-4-ynyl, 2-methylpent-4-ynyl, 1-methyl-pent-4-ynyl, 2-methyl-pent-3-ynyl, 1-methylpent-3-ynyl, 4-methylpent-2-ynyl, 1-methyl-pent-2-ynyl, 4-methylpent-1-ynyl, 3-methylpent-1-ynyl, 2-ethylbut-3-ynyl, 1-ethylbut-3-ynyl, 1-ethylbut-2-ynyl, 1-propylprop-2-ynyl, 1-isopropylprop-2-ynyl, 2,2-dimethylbut-3-ynyl, 1,1-dimethylbut-3-ynyl, 1,1-dimethylbut-2-ynyl or 3,3-dimethylbut-1-ynyl group.

The term “C₁-C₆-haloalkyl” as used herein refers to a C₁-C₆-alkyl group as defined above in which one or more hydrogen atoms are replaced with one or more halogen atoms that may be the same or different.

The term “C₂-C₆-haloalkenyl” as used herein refers to a C₂-C₆-alkenyl group as defined above in which one or more hydrogen atoms are replaced with one or more halogen atoms that may be the same or different.

The term “C₂-C₆-haloalkynyl” as used herein refers to a C₂-C₆-alkynyl group as defined above in which one or more hydrogen atoms are replaced with one or more halogen atoms that may be the same or different.

The term “C₁-C₆-alkoxy” as used herein refers to a group of formula (C₁-C₆-alkyl)-O—, in which the term “C₁-C₆-alkyl” is as defined herein. Examples of C₁-C₆-alkoxy include but are not limited to methoxy, ethoxy, n-propoxy, 1-methylethoxy, n-butoxy, 1-methylpropoxy, 2-methylpropoxy, 1,1-dimethylethoxy, n-pentoxy, 1-methylbutoxy, 2-methylbutoxy, 3-methylbutoxy, 2,2-dimethylpropoxy, 1-ethylpropoxy, 1,1-dimethylpropoxy, 1,2-dimethylpropoxy, n-hexyloxy, 1-methylpentoxy, 2-methylpentoxy, 3-methylpentoxy, 4-methylpentoxy, 1,1-dimethylbutoxy, 1,2-dimethylbutoxy, 1,3-dimethylbutoxy, 2,2-dimethylbutoxy, 2,3-dimethylbutoxy, 3,3-dimethylbutoxy, 1-ethylbutoxy, 2-ethylbutoxy, 1,1,2-trimethylpropoxy, 1,2,2-trimethylpropoxy, 1-ethyl-1-methylpropoxy and 1-ethyl-2-methylpropoxy.

The term “C₁-C₆-haloalkoxy” as used herein refers to a C₁-C₆-alkoxy group as defined above in which one or more hydrogen atoms are replaced with one or more halogen atoms that may be the same or different. Examples of C₁-C₆-haloalkoxy include but are not limited to chloromethoxy, bromomethoxy, dichloromethoxy, trichloromethoxy, fluoromethoxy, difluoromethoxy, trifluoromethoxy, chlorofluoro-methoxy, dichlorofluoromethoxy, chlorodifluoromethoxy, 1-chloroethoxy, 1-bromoethoxy, 1-fluoroethoxy, 2-fluoroethoxy, 2,2-difluoroethoxy, 2,2,2-trifluoroethoxy, 2-chloro-2-fluoroethoxy, 2-chloro-2,2-difluoroethoxy, 2,2-dichloro-2-fluoroethoxy, 2,2,2-trichloroethoxy, pentafluoroethoxy and 1,1,1-trifluoroprop-2-oxy.

The term “C₁-C₆-haloalkoxy” as used herein refers to a C₁-C₆-alkoxy group as defined above in which one or more hydrogen atoms are replaced with one or more halogen atoms that may be the same or different.

The term “C₁-C₆-hydroxyalkyl” as used herein refers to a C₁-C₆-alkyl group as defined above in which at least one hydrogen atom is replaced with a hydroxyl group. Examples of C₁-C₆-hydroxyalkyl include but are not limited to hydroxymethyl, 1-hydroxyethyl, 2-hydroxyethyl,1,2-dihydroxyethyl, 3-hydroxypropyl, 2-hydroxypropyl, 1-hydroxypropyl, 1-hydroxypropan-2-yl, 2-hydroxypropan-2-yl, 2, 3-dihydroxypropyl and 1,3-dihydroxypropan-2-yl.

The term “C₁-C₆-alkylsulfanyl” as used herein refers to a saturated, linear or branched group of formula (C₁-C₆-alkyl)-S—, in which the term “C₁-C₆-alkyl” is as defined herein. Examples of C₁-C₆-alkylsulfanyl include but are not limited to methylsulfanyl, ethylsulfanyl, propylsulfanyl, isopropylsulfanyl, butylsulfanyl, sec-butylsulfanyl, isobutylsulfanyl, tert-butylsulfanyl, pentylsulfanyl, isopentylsulfanyl, hexylsulfanyl group.

The term “C₁-C₆-haloalkylsulfanyl” as used herein refers to a C₁-C₆-alkylsulfanyl as defined above in which one or more hydrogen atoms are replaced with one or more halogen atoms that may be the same or different.

The term “C₁-C₆-alkylsulfinyl” as used herein refers to a saturated, linear or branched group of formula (C₁-C₆-alkyl)-S(═O)—, in which the term “C₁-C₆-alkyl” is as defined herein. Examples of C₁-C₆-alkylsulfinyl include but are not limited to saturated, straight-chain or branched alkylsulfinyl radicals having 1 to 8, preferably 1 to 6 and more preferably 1 to 4 carbon atoms, for example (but not limited to) C₁-C₆-alkylsulfinyl such as methylsulfinyl, ethylsulfinyl, propylsulfinyl, 1-methylethylsulfinyl, butyl-sulfinyl, 1-methylpropylsulfinyl, 2-methylpropylsulfinyl, 1,1-dimethylethylsulfinyl, pentylsulfinyl, 1-methylbutylsulfinyl, 2-methylbutylsulfinyl, 3-methylbutylsulfinyl, 2,2-dimethylpropylsulfinyl, 1-ethyl-propylsulfinyl, 1,1-dimethylpropylsulfinyl, 1,2-dimethylpropylsulfinyl, hexylsulfinyl, 1-methylpentylsulfinyl, 2-methylpentylsulfinyl, 3-methylpentylsulfinyl, 4-methylpentylsulfinyl, 1,1-dimethylbutylsulfinyl, 1,2-dimethylbutylsulfinyl, 1,3-dimethylbutylsulfinyl, 2,2-dimethylbutylsulfinyl, 2,3-dimethylbutylsulfinyl, 3,3-dimethylbutylsulfinyl, 1-ethylbutylsulfinyl, 2-ethylbutylsulfinyl, 1,1,2-trimethylpropylsulfinyl, 1,2,2-trimethylpropylsulfinyl, 1-ethyl-1-methylpropylsulfinyl and 1-ethyl-2-methylpropylsulfinyl.

The term “C₁-C₆-haloalkylsulfinyl” as used herein refers to a C₁-C₆-alkylsulfinyl as defined above in which one or more hydrogen atoms are replaced with one or more halogen atoms that may be the same or different.

The term “C₁-C₆-alkylsulfonyl” s used herein refers to a saturated, linear or branched group of formula (C₁-C₆-alkyl)-S(═O)₂—, in which the term “C₁-C₆-alkyl” is as defined herein. Examples of C₁-C₆-alkylsulfonyl include but are not limited to methylsulfonyl, ethylsulfonyl, propylsulfonyl, 1-methylethyl-sulfonyl, butylsulfonyl, 1-methylpropylsulfonyl, 2-methylpropylsulfonyl, 1,1-dimethylethylsulfonyl, pentylsulfonyl, 1-methylbutylsulfonyl, 2-methylbutylsulfonyl, 3-methylbutylsulfonyl, 2,2-dimethylpropylsulfonyl, 1-ethylpropylsulfonyl, 1,1-dimethylpropylsulfonyl, 1,2-dimethylpropylsulfonyl, hexyl-sulfonyl, 1-methylpentylsulfonyl, 2-methylpentylsulfonyl, 3-methylpentylsulfonyl, 4-methylpentylsulfonyl, 1,1-dimethylbutylsulfonyl, 1,2-dimethylbutylsulfonyl, 1,3-dimethylbutylsulfonyl, 2,2-dimethylbutylsulfonyl, 2,3-dimethylbutylsulfonyl, 3,3-dimethylbutylsulfonyl, 1-ethylbutylsulfonyl, 2-ethylbutylsulfonyl, 1,1,2-trimethylpropylsulfonyl, 1,2,2-trimethylpropylsulfonyl, 1-ethyl-1-methylpropylsulfonyl and 1-ethyl-2-methylpropylsulfonyl.

The term “C₁-C₆-haloalkylsulfonyl” as used herein refers to a C₁-C₆-alkylsulfonyl as defined above in which one or more hydrogen atoms are replaced with one or more halogen atoms that may be the same or different.

The term “C₁-C₆-alkylcarbonyl” as used herein refers to a saturated, linear or branched group of formula (C₁-C₆-alkyl)-C(═O)—, in which the term “C₁-C₆-alkyl” is as defined herein.

The term “C₁-C₆-haloalkylcarbonyl” as used herein refers to a C₁-C₆-alkylcarbonyl as defined above in which one or more hydrogen atoms are replaced with one or more halogen atoms that may be the same or different.

The term “C₁-C₆-alkoxycarbonyl” as used herein refers to a saturated, linear or branched group of formula (C₁-C₆-alkoxy)-C(═O)—, in which the term “C₁-C₆-alkoxy” is as defined herein.

The term “C₁-C₆-haloalkoxycarbonyl” as used herein refers to a C₁-C₆-alkoxycarbonyl as defined above in which one or more hydrogen atoms are replaced with one or more halogen atoms that may be the same or different.

The term “C₁-C₆-dialkylamino” as used herein refers to an amino radical having two independently selected C₁-C₆-alkyl groups as defined herein. Examples of C₁-C₆-dialkylamino include but are not limited to N,N-dimethylamino, N,N-diethylamino, N,N-diisopropylamino, N-ethyl-N-methylamino, N-methyl-N-n-propylamino, N-isopropyl-N-n-propylamino and N-tert-butyl-N-methylamino

The term “non-aromatic C₃-C₁₂-carbocycle” as used herein refers to a non-aromatic, saturated or unsaturated, hydrocarbon ring system in which all of the ring members, which vary from 3 to 12, are carbon atoms. The ring system may be monocyclic or polycyclic (fused, spiro or bridged). Non-aromatic C₃-C₁₂-carbocycles include but are not limited to C₃-C₁₂-cycloalkyl (mono or bicyclic), C₃-C₁₂-cycloalkenyl (mono or bicyclic), bicyclic system comprising an aryl (e.g. phenyl) fused to a monocyclic C₃-C₈-cycloalkyl (e.g. tetrahydronaphthalenyl, indanyl), bicyclic system comprising an aryl (e.g. phenyl) fused to a monocyclic C₃-C₈-cycloalkenyl (e.g. indenyl, dihydronaphthalenyl) and tricyclic system comprising a cyclopropyl connected through one carbon atom to a bicyclic system comprising an aryl (e.g. phenyl) fused to a monocyclic C₃-C₈-cycloalkyl or to a monocyclic C₃-C₈-cycloalkenyl. The non-aromatic C₃-C₁₂-carbocycle can be attached to the parent molecular moiety through any carbon atom.

The term “C₃-C₁₂-cycloalkyl” as used herein refers to a saturated, monovalent, mono- or bicyclic hydrocarbon ring which contains 3, 4, 5, 6, 7, 8, 9, 10, 11 or 12 carbon atoms. Examples of monocyclic C₃-C₈-cycloalkyls include but are not limited to cyclopropyl, cyclobutyl, cyclopentyl, cyclohexyl, cyclo-heptyl, or cyclooctyl. Examples of bicyclic C₆-C₁₂-cycloalkyls include but are not limited to bicyclo[3.1.1]heptane, bicyclo[2.2.1]heptane, bicyclo[2.2.2]octane, bicyclo[3.2.2]nonane, bicyclo[3.3.1]nonane, bicyclo[4.2.0]octyl, octahydropentalenyl and bicyclo[4.2.1]nonane.

The term “C₃-C₁₂-cycloalkenyl” as used herein refers to an unsaturated, monovalent, mono- or bicyclic hydrocarbon ring which contains 3, 4, 5, 6, 7, 8, 9, 10, 11 or 12 carbon atoms. Examples of monocyclic C₃-C₈-cycloalkenyl group include but are not limited to cyclobutenyl, cyclopentenyl, cyclohexenyl, cyclo-heptenyl and cyclooctenyl group. Examples of bicyclic C₆-C₁₂-cycloalkenyl group include but are not limited to bicyclo[2.2.1]hept-2-enyl or bicyclo[2.2.2]oct-2-enyl.

The term “aromatic C₆-C₁₄-carbocycle” or “aryl” as used herein refers to an aromatic hydrocarbon ring system in which all of the ring members, which vary from 6 to 14, preferably from 6 to 10, are carbon atoms. The ring system may be monocyclic or fused polycyclic (e.g. bicyclic or tricyclic). Examples of aryl include but are not limited to phenyl, azulenyl and naphthyl. The aryl can be attached to the parent molecular moiety through any carbon atom. It is further understood that when said aryl group is substituted with one or more substituents, said substituent(s) may be at any positions on said aryl ring(s). Particularly, in the case of aryl being a phenyl group, said substituent(s) may occupy one or both ortho positions, one or both meta positions, or the para position, or any combination of these positions.

The term “non-aromatic 3- to 14-membered heterocycle” as used herein refers to a saturated or unsaturated non-aromatic ring system comprising 1 to 4 heteroatoms independently selected from the group consisting of oxygen, nitrogen and sulfur. If the ring system contains more than one oxygen atoms, they are not directly adjacent. Non aromatic heterocycles include but are not limited to 3- to 7-membered monocyclic non-aromatic heterocycles and 6- to 14-membered polycyclic (e.g. bicyclic or tricyclic) non-aromatic heterocycles. The non-aromatic 3- to 14-membered heterocycle can be connected to the parent molecular moiety through any carbon atom or nitrogen atom contained within the heterocycle.

The term “non-aromatic 3- to 7-membered monocyclic heterocycle” as used herein refers to a 3-, 4-, 5-, 6- or 7-membered monocyclic ring system containing 1, 2 or 3 heteroatoms independently selected from the group consisting of oxygen, nitrogen and sulfur where the ring system is saturated or unsaturated but not aromatic. For instance, the heterocycle may comprise one to three nitrogen atoms, or one or two oxygen atoms, or one or two sulfur atoms, or one to three nitrogen atoms and one oxygen atom, or one to three nitrogen atoms and a sulfur atom or one sulfur atom and one oxygen atom. Examples of saturated non-aromatic heterocycles include but are not limited to 3-membered ring such as oxiranyl, aziridinyl, 4-membered ring such as azetidinyl, oxetanyl, thietanyl, 5-membered ring such as tetrahydrofuranyl, 1,3-dioxolanyl, tetrahydrothienyl, pyrrolidinyl, pyrazolidinyl, imidazolidinyl, triazolidinyl, isoxazolidinyl, oxazolidinyl, oxadiazolidinyl, thiazolidinyl, isothiazolidinyl, thiadiazolidinyl, 6-membered ring such as piperidinyl, hexahydropyridazinyl, hexahydropyrimidinyl, piperazinyl, triazinanyl, hexahydrotriazinyl, tetrahydropyranyl, dioxanyl, tetrahydrothiopyranyl, dithianyl, morpholinyl, 1,2-oxazinanyl, oxathianyl, thiomorpholinyl or 7-membered ring such as oxepanyl, azepanyl, 1,4-diazepanyl and 1,4-oxazepanyl. Examples of unsaturated non-aromatic hererocycles include but are not limited to 5-membered ring such as dihydrofuranyl, 1,3-dioxolyl, dihydrothienyl, pyrrolinyl, dihydroimidazolyl, dihydropyrazolyl, isoxazolinyl, dihydrooxazolyl, dihydrothiazolyl or 6-membered ring such as pyranyl, thiopyranyl, thiazinyl and thiadiazinyl.

The term “non-aromatic 6- to 14-membered polycyclic heterocycle” as used herein refers to a 6-, 7-, 8-, 9-, 10-, 11-, 12-, 13- or 14-membered polycyclic (e.g. bicyclic or tricyclic) ring system containing 1, 2 or 3 heteroatoms independently selected from the group consisting of oxygen, nitrogen and sulfur where the ring system is saturated or unsaturated but not aromatic. Non-aromatic bicyclic heterocycles may consist of a monocyclic heteroaryl as defined herein fused to a monocyclic C₃-C₈-cycloalkyl, a monocyclic C₃-C₈-cycloalkenyl or a monocyclic non-aromatic heterocycle or may consist of a monocyclic non-aromatic heterocycle fused either to an aryl (e.g. phenyl), a monocyclic C₃-C₈-cycloalkyl, a monocyclic C₃-C₈-cycloalkenyl or a monocyclic non-aromatic heterocycle. When two monocyclic heterocycles (aromatic or non-aromatic) comprising nitrogen atoms are fused, nitrogen atom may be at the bridgehead (e.g. 4,5,6,7-tetrahydropyrazolo[1,5-a]pyridinyl, 5,6,7,8-tetrahydro-[1,2,4]triazolo[1,5-a]pyridinyl, 5,6,7,8-tetrahydroimidazo[1,2-a]pyridinyl). Non-aromatic tricyclic heterocycles may consist of a monocyclic cycloalkyl connected through one common atom to a non-aromatic bicyclic heterocycle.

The term “aromatic 5- to 14-membered heterocycle” or “heteroaryl” as used herein refers to an aromatic ring system comprising 1 to 4 heteroatoms independently selected from the group consisting of oxygen, nitrogen and sulfur. If the ring system contains more than one oxygen atom, they are not directly adjacent. Aromatic heterocycles include aromatic 5- or 6-membered monocyclic heterocycles and 6- to 14-membered polycyclic (e.g. bicyclic or tricyclic) aromatic heterocycles. The 5- to 14-membered aromatic heterocycle can be connected to the parent molecular moiety through any carbon atom or nitrogen atom contained within the heterocycle.

The term “aromatic 5- or 6-membered monocyclic heterocycle” or “monocyclic heteroaryl” as used herein refers to a 5- or 6-membered monocyclic ring system containing 1, 2, 3 or 4 heteroatoms independently selected from the group consisting of oxygen, nitrogen and sulfur. Examples of 5-membered monocyclic heteroaryl include but are not limited to furyl (furanyl), thienyl, pyrrolyl, pyrazolyl, imidazolyl, triazolyl, tetrazolyl, isoxazolyl, oxazolyl, oxadiazolyl, oxatriazolyl, isothiazolyl, thiazolyl, thiadiazolyl and thiatriazolyl. Examples of 6-membered monocyclic heteroaryl include but are not limited to pyridinyl, pyridazinyl, pyrimidinyl, pyrazinyl, triazinyl, tetrazinyl.

The term “6- to 14-membered polycyclic aromatic heterocycle” or “polycyclic heteroaryl” as used herein refers to a 6-, 7-, 8-, 9-, 10-, 11-, 12-, 13- or 14-membered polycyclic (e.g. bicyclic or tricyclic) ring system containing 1, 2 or 3 heteroatoms independently selected from the group consisting of oxygen, nitrogen and sulfur. Aromatic bicyclic heterocycles may consist of a monocyclic heteroaryl as defined herein fused to an aryl (e.g. phenyl) or to a monocyclic heteroaryl. Examples of bicyclic aromatic heterocycle include but are not limited to 9-membered ring such as indolyl, indolizinyl, isoindolyl, benzimadozolyl, imidazopyridinyl, indazolyl, benzotriazolyl, purinyl, benzofuranyl, benzothiophenyl, benzothiazolyl, benzoxazolyl and benzisoxazolyl or 10-membered ring such as quinolinyl, isoquinolinyl, cinnolinyl, quinazolinyl, quinoxalinyl, phthalazinyl, naphthyridinyl, pteridinol and benzodioxinyl. In 9- or 10-membered aromatic bicyclic heterocycles comprising two fused 5- or 6-membered monocyclic aromatic heterocycles, nitrogen atom may be at the bridgehead (e.g. imidazo[1,2-a]pyridinyl, [1,2,4]triazolo[4,3-a]pyridinyl, imidazo[1,2-a]pyridinyl, imidazo[2,1-b]oxazolyl, furo[2,3-d]isoxazolyl). Examples of tricyclic aromatic heterocycle include but are not limited to carbazolyl, acridinyl and phenazinyl.

The terms “non-aromatic C₃-C₁₂-carbocyclyloxy”, “C₃-C₈-cycloalkyloxy”, “aromatic C₆-C₁₄-carbocyclyloxy”, “aromatic 5- to 14-membered heterocyclyloxy”, “non-aromatic 3- to 14-membered heterocyclyloxy” as used herein designate a group of formula —O—R wherein R is respectively a non-aromatic C₃-C₁₂-carbocyclyl, a C₃-C₈-cycloalkyl, an aromatic C₆-C₁₄-carbocyclyl, an aromatic 5- to 14-membered heterocyclyl or a non-aromatic 3- to 14-membered heterocyclyl group as defined herein.

As used herein, when a group is said to be “substituted”, the group may be substituted with one or more substituents. The expression “one or more substituents” refers to a number of substituents that ranges from one to the maximum number of substituents possible based on the number of available bonding sites, provided that the conditions of stability and chemical feasibility are met.

The term “leaving group” as used herein is to be understood as meaning a group which is displaced from a compound in a substitution or an elimination reaction, for example a halogen atom, a trifluoromethanesulphonate (“triflate”) group, alkoxy, methanesulphonate, p-toluenesulphonate, etc.

The terms “as described herein” when referring to a variable Q, T, R¹, R², R³, R⁴, R⁵, R⁶, R⁷, R⁸, n and m incorporates by reference the broad definition of the variable as well as preferred, more preferred and even more preferred definitions, if any.

Not encompassed herein are compounds resulting from combinations which are against natural laws and which the person skilled in the art would therefore exclude based on his/her expert knowledge. For instance, ring structures having three or more adjacent oxygen atoms are excluded.

The compounds of formula (I) can suitably be in their free form, salt form, N-oxide form or solvate form (e.g. hydrate).

Depending on the nature of the substituents, the compound of formula (I) may be present in the form of different stereoisomers. These stereoisomers are, for example, enantiomers, diastereomers, atropisomers or geometric isomers. Accordingly, the invention encompasses both pure stereoisomers and any mixture of these isomers. Where a compound can be present in two or more tautomer forms in equilibrium, reference to the compound by means of one tautomeric description is to be considered to include all tautomer forms.

Any of the compounds of the present invention can also exist in one or more geometric isomer forms depending on the number of double bonds in the compound. Geometric isomers by nature of substituents about a double bond or a ring may be present in cis (=Z-) or trans (=E-) form. The invention thus relates equally to all geometric isomers and to all possible mixtures, in all proportions.

Depending on the nature of the substituents, the compound of formula (I) may be present in the form of the free compound and/or a salt thereof, such as an agrochemically active salt.

Agrochemically active salts include acid addition salts of inorganic and organic acids well as salts of customary bases. Examples of inorganic acids are hydrohalic acids, such as hydrogen fluoride, hydrogen chloride, hydrogen bromide and hydrogen iodide, sulfuric acid, phosphoric acid and nitric acid, and acidic salts, such as sodium bisulfate and potassium bisulfate. Useful organic acids include, for example, formic acid, carbonic acid and alkanoic acids such as acetic acid, trifluoroacetic acid, trichloroacetic acid and propionic acid, and also glycolic acid, thiocyanic acid, lactic acid, succinic acid, citric acid, benzoic acid, cinnamic acid, oxalic acid, saturated or mono- or diunsaturated fatty acids having 6 to 20 carbon atoms, alkylsulphuric monoesters, alkylsulphonic acids (sulphonic acids having straight-chain or branched alkyl radicals having 1 to 20 carbon atoms), arylsulphonic acids or aryldisulphonic acids (aromatic radicals, such as phenyl and naphthyl, which bear one or two sulphonic acid groups), alkylphosphonic acids (phosphonic acids having straight-chain or branched alkyl radicals having 1 to 20 carbon atoms), arylphosphonic acids or aryldiphosphonic acids (aromatic radicals, such as phenyl and naphthyl, which bear one or two phosphonic acid radicals), where the alkyl and aryl radicals may bear further substituents, for example p-toluenesulphonic acid, salicylic acid, p-aminosalicylic acid, 2-phenoxybenzoic acid, 2-acetoxybenzoic acid, etc.

Solvates of the compounds of the invention or their salts are stoichiometric compositions of the compounds with solvents.

The compounds of the invention may exist in multiple crystalline and/or amorphous forms. Crystalline forms include unsolvated crystalline forms, solvates and hydrates.

Aliphatic R^{6S} substituents as used herein in the expression “aliphatic R^{6S}, R^{c} and R^{d} substituents may be substituted with one or more substituents” designate C₁-C₆-alkyl, C₁-C₆ haloalkyl, C₁-C₆-alkoxy, C₁-C₆-haloalkoxy, C₂-C₆-alkenyl, C₂-C₆-haloalkenyl, C₂-C₆-alkynyl, C₂-C₆-haloalkynyl, C₂-C₆-alkenyloxy, C₂-C₆-haloalkenyloxy, C₁-C₆-alkylsulfanyl, C₁-C₆-haloalkylsulfanyl, C₁-C₆ alkylsulfinyl, C₁-C₆-haloalkylsulfinyl, C₁-C₆-alkylsulfonyl, C₁-C₆-haloalkylsulfonyl and the C₁-C₆-alkyl moiety of —Si(C₁-C₆-alkyl)₃ and —O—Si(C₁-C₆-alkyl)₃.

Aliphatic R^{c} substituents as used herein in the expression “aliphatic R^{6S}, R^{c} and R^{d} substituents may be substituted with one or more substituents” designate C₁-C₆-alkyl.

Aliphatic R^{d} substituents as used herein in the expression “aliphatic R^{6S}, R^{c} and R^{d} substituents may be substituted with one or more substituents” designate C₁-C₆-alkyl and C₁-C₆-haloalkyl.

Aliphatic R⁷ substituents as used herein in the expression “aliphatic R⁷, R^{e}, R^{f} and R^{g} substituents may be substituted with one or more R^{7Sa} substituents” designate C₁-C₆-alkyl, C₁-C₆ haloalkyl, C₁-C₆-hydroxyalkyl, C₁-C₆-alkylcarbonyl, C₁-C₆-haloalkylcarbonyl, C₁-C₆-alkoxy, C₁-C₆-haloalkoxy, C₁-C₆-alkoxycarbonyl, C₁-C₆-haloalkoxycarbonyl, C₂-C₆-alkenyl, C₂-C₆-haloalkenyl, C₂-C₆-alkynyl, C₂-C₆-haloalkynyl, C₂-C₆-alkenyloxy, C₂-C₆-haloalkenyloxy, C₂-C₆-alkynyloxy, C₂-C₆-haloalkynyloxy, C₁-C₆-alkylsulfanyl, C₁-C₆-haloalkylsulfanyl, C₁-C₆ alkylsulfinyl, C₁-C₆ haloalkylsulfinyl, C₁-C₆-alkylsulfonyl, C₁-C₆-haloalkylsulfonyl and the C₁-C₆-alkyl moiety of —Si(C₁-C₆-alkyl)₃ and —O—Si(C₁-C₆-alkyl)₃.

Aliphatic R^{e} substituents as used herein in the expression “aliphatic R⁷, R^{e}, R^{f} and R^{g} substituents may be substituted with one or more R^{7Sa} substituents” designate C₁-C₆-alkyl, C₁-C₆ haloalkyl, C₁-C₆-alkoxy, C₂-C₆-alkenyl, C₂-C₆-haloalkenyl, C₂-C₆-alkynyl and C₂-C₆-haloalkynyl.

Aliphatic R^{f} substituents as used herein in the expression “aliphatic R⁷, R^{e}, R^{f} and R^{g} substituents may be substituted with one or more R^{7Sa} substituents” designate C₁-C₆-alkyl, C₁-C₆ haloalkyl, C₁-C₆-alkoxy and the C₁-C₆-alkyl moiety of C₁-C₆-alkylamino and di(C₁-C₆-alkyl)amino

Aliphatic R^{g} substituents as used herein in the expression “aliphatic R⁷, R^{e}, R^{f} and R^{g} substituents may be substituted with one or more R^{7Sa} substituents” designate C₁-C₆-alkyl and C₁-C₆-haloalkyl.

Aliphatic R⁸ substituents as used herein in the expression “aliphatic R⁸, R^{h} and Rⁱ substituents may be substituted with one or more R^{8Sa} substituents” designate C₁-C₆-alkyl, C₁-C₆ haloalkyl, C₁-C₆-hydroxyalkyl, C₁-C₆-alkoxy, C₁-C₆-haloalkoxy, C₂-C₆-alkenyl, C₂-C₆-haloalkenyl, C₂-C₆-alkynyl, C₂-C₆-haloalkynyl, C₂-C₆-alkenyloxy, C₂-C₆-haloalkenyloxy, C₂-C₆-alkynyloxy, C₂-C₆-haloalkynyloxy, C₁-C₆-alkylsulfanyl, C₁-C₆-haloalkylsulfanyl, C₁-C₆ alkylsulfinyl, C₁-C₆ haloalkylsulfinyl, C₁-C₆-alkylsulfonyl, C₁-C₆-haloalkylsulfonyl and the C₁-C₆-alkyl moiety of —Si(C₁-C₆-alkyl)₃ and —O—Si(C₁-C₆-alkyl)₃.

Aliphatic R^{h} substituents as used herein in the expression “aliphatic R⁸, R^{h} and Rⁱ substituents may be substituted with one or more R^{8Sa} substituents” designate C₁-C₆-alkyl, C₁-C₆ haloalkyl, C₁-C₆-alkoxy, C₂-C₆ alkenyl, C₂-C₆haloalkenyl, C₂-C₆ alkynyl and C₂-C₆haloalkynyl.

Aliphatic Rⁱ substituents as used herein in the expression “aliphatic R⁸, R^{h} and Rⁱ substituents may be substituted with one or more R^{8Sa} substituents” designate C₂-C₆ alkenyl, C₂-C₆haloalkenyl, C₂-C₆ alkynyl and C₂-C₆haloalkynyl.

Aliphatic Q^{S} substituents as used herein in the expression “aliphatic Q^{S}, R^{j} and R^{k} substituents may be substituted with one or more substituents” designate C₁-C₆-alkyl, C₁-C₆ haloalkyl, C₁-C₆-alkylcarbonyl, C₁-C₆-haloalkylcarbonyl, C₁-C₆-alkoxy, C₁-C₆-haloalkoxy, C₁-C₆ alkoxy C₁-C₆ alkyl, C₁-C₆-alkoxycarbonyl, C₁-C₆-haloalkoxycarbonyl, C₂-C₆ alkenyl, C₂-C₆haloalkenyl, C₂-C₆-alkynyl, C₂-C₆-haloalkynyl, C₂-C₆-alkenyloxy, C₂-C₆-haloalkenyloxy, C₁-C₆-alkylsulfanyl, C₁-C₆-haloalkylsulfanyl, C₁-C₆-alkylsulfinyl, C₁-C₆ haloalkylsulfinyl, C₁-C₆-alkylsulfonyl, C₁-C₆-haloalkylsulfonyl and the C₁-C₆-alkyl moiety of —Si(C₁-C₆-alkyl)₃ and —O—Si(C₁-C₆-alkyl)₃.

Aliphatic R^{j} substituents as used herein in the expression “aliphatic Q^{S}, R^{j} and R^{k} substituents may be substituted with one or more substituents” designate C₁-C₆-alkyl, C₁-C₆-haloalkyl and C₁-C₆-alkoxy.

Aliphatic R^{k} substituents as used herein in the expression “aliphatic Q^{S}, R^{j} and R^{k} substituents may be substituted with one or more substituents” designate C₁-C₆-alkyl, C₁-C₆ haloalkyl, C₁-C₆-alkoxy, C₂-C₆ alkenyl and C₂-C₆haloalkenyl.

Cyclic R⁶ substituents as used herein in the expression “cyclic, or cyclic moiety of, R⁶ substituents may be substituted with one or more R^{6S} substituents” designate non-aromatic C₃-C₁₂-carbocycle, aromatic C₆-C₁₄-carbocycle, non-aromatic 3- to 14-membered heterocycle and aromatic 5- to 14-membered heterocycle.

Cyclic moiety of R⁶ substituents as used herein in the expression “cyclic, or cyclic moiety of, R⁶ substituents may be substituted with one or more R^{6S} substituents” designate the non-aromatic C₃-C₁₂-carbocycle of non-aromatic C₃-C₁₂-carbocyclyloxy, the aromatic C₆-C₁₄-carbocyclyl of aromatic C₆-C₁₄-carbocyclyloxy, the aromatic 5- to 14-membered heterocycle of aromatic 5- to 14-membered heterocyclyloxy, the non-aromatic 3- to 14-membered heterocycle of non-aromatic 3- to 14-membered heterocyclyloxy, the non-aromatic C₃-C₁₂-carbocycle of C₁-C₃-alkoxy substituted by a non-aromatic C₃-C₁₂-carbocycle, the aromatic C₆-C₁₄-carbocycle of C₁-C₃-alkoxy substituted by an aromatic C₆-C₁₄-carbocycle, the non-aromatic 3- to 14-membered heterocycle of C₁-C₃-alkoxy substituted by a non-aromatic 3- to 14-membered heterocycle, the aromatic 5- to 14-membered heterocycle of C₁-C₃-alkoxy substituted by an aromatic 5- to 14-membered heterocycle, the non-aromatic C₃-C₁₂-carbocycle of C₁-C₃-haloalkoxy substituted by a non-aromatic C₃-C₁₂-carbocycle, the aromatic C₆-C₁₄-carbocycle of C₁-C₃-haloalkoxy substituted by an aromatic C₆-C₁₄-carbocycle, the non-aromatic 3- to 14-membered heterocycle of C₁-C₃-haloalkoxy substituted by a non-aromatic 3- to 14-membered heterocycle and the aromatic 5- to 14-membered heterocycle of C₁-C₃-haloalkoxy substituted by an aromatic 5- to 14-membered heterocycle.

Cyclic R^{6S} substituents as used herein in the expression “cyclic R^{6S} and R^{c} substituents may be substituted with one or more substituents” designate C₃-C₈-cycloalkyl, C₃-C₈-cycloalkenyl, aromatic C₆-C₁₄-carbocycle, aromatic 5- or 6-membered monocyclic heterocycle and non-aromatic 3- to 7-membered monocyclic heterocycle.

Cyclic moiety of R^{6S} substituents as used herein in the expression “cyclic or cyclic moiety of R^{6S} and cyclic R^{c} substituents may be substituted with one or more substituents” designate the C₃-C₈-cycloalkyl of C₃-C₈-cycloalkyloxy, C₃-C₈-cycloalkylsulfanyl, C₃-C₈-cycloalkylsulfinyl, and C₃-C₈-cycloalkylsulfonyl

Cyclic R^{c} substituents as used herein in the expression “cyclic or cyclic moiety of R^{6S} and cyclic R^{c} substituents may be substituted with one or more substituents” designate C₃-C₈-cycloalkyl.

Cyclic R⁷ substituents as used herein in the expression “cyclic R⁷, R^{e} and R^{g} substituents may be substituted with one or more R^{7Sc} substituents” designate C₃-C₈-cycloalkyl, C₃-C₆-cycloalkenyl, aromatic C₆-C₁₄-carbocycle, aromatic 5- or 6-membered monocyclic heterocycle and non-aromatic 3- to 7-membered monocyclic heterocycle.

Cyclic moiety of R⁷ substituents as used herein in the expression “cyclic or cyclic moiety of R⁷, cyclic R^{e} and cyclic R^{g} substituents may be substituted with one or more R^{7Sc} substituents” designate the C₃-C₈-cycloalkyl of C₃-C₈-cycloalkyloxy, C₃-C₈-cycloalkylsulfanyl, C₃-C₈-cycloalkylsulfinyl and C₃-C₈-cycloalkylsulfonyl, the aromatic C₆-C₁₄-carbocycle of aromatic C₆-C₁₄-carbocyclyloxy, the aromatic 5- or 6-membered monocyclic heterocycle of aromatic 5- or 6-membered monocyclic heterocyclyloxy and the non-aromatic 3- to 7-membered monocyclic heterocycle of non-aromatic 3- to 7-membered monocyclic heterocyclyloxy.

Cyclic R^{e} substituents as used herein in the expression “cyclic R⁷, R^{e} and R^{g} substituents may be substituted with one or more R^{7Sc} substituents” designate C₃-C₈-cycloalkyl, C₃-C₈-halocycloalkyl, aromatic C₆-C₁₄-carbocycle, aromatic 5- or 6-membered monocyclic heterocycle and non-aromatic 3- to 7-membered monocyclic heterocycle.

Cyclic R^{g} substituents” as used herein in the expression “cyclic R⁷, R^{e} and R^{g} substituents may be substituted with one or more R^{7Sc} substituents” designate C₃-C₈-cycloalkyl.

Cyclic R⁸ substituents as used herein in the expression “wherein cyclic R⁸, R^{h} and Rⁱ substituents may be substituted with one or more R^{8Sc} substituents” designate C₃-C₈-cycloalkyl, C₃-C₆-cycloalkenyl, aromatic C₆-C₁₄-carbocycle, non-aromatic 3- to 14-membered heterocycle and aromatic 5- to 14-membered heterocycle.

Cyclic moiety of R⁸ substituents as used herein in the expression “wherein cyclic or cyclic moiety of R⁸, cyclic R^{h} and cyclic Rⁱ substituents may be substituted with one or more R^{8Sc} substituents” designate the C₃-C₈-cycloalkyl of C₃-C₈-cycloalkyloxy, the aromatic C₆-C₁₄-carbocycle of aromatic C₆-C₁₄-carbocyclyloxy, the non-aromatic 3- to 14-membered heterocycle of non-aromatic 3- to 14-membered heterocyclyloxy and the aromatic 5- to 14-membered heterocycle of aromatic 5- to 14-membered heterocyclyloxy.

Cyclic R^{h} substituents as used herein in the expression “wherein cyclic or cyclic moiety of R⁸, cyclic R^{h} and cyclic Rⁱ substituents may be substituted with one or more R^{8Sc} substituents” designate C₃-C₈-cycloalkyl, C₃-C₈-halocycloalkyl, aromatic C₆-C₁₄-carbocycle, aromatic 5- to 14-membered heterocycle and non-aromatic 3- to 7-membered monocyclic heterocycle.

Cyclic Rⁱ substituents as used herein in the expression “wherein cyclic R⁸, R^{h} and Rⁱ substituents may be substituted with one or more R^{8Sc} substituents” designate C₃-C₈-cycloalkyl, C₃-C₈-halocycloalkyl, aromatic C₆-C₁₄-carbocycle, aromatic 5- to 14-membered heterocycle and non-aromatic 3- to 7-membered monocyclic heterocycle.

Cyclic Q^{S} substituents as used herein in the expression “cyclic or cyclic moiety of Q^{S} and cyclic R^{k} substituents may be substituted with one or more R^{Qs} substituents” designate C₃-C₈-cycloalkyl, C₃-C₆-cycloalkenyl, non-aromatic 3- to 7-membered monocyclic heterocycle and aromatic 5- to 14-membered heterocycle.

Cyclic moiety of Q^{S} substituents as used herein in the expression “cyclic or cyclic moiety of Q^{S} and cyclic substituents may be substituted with one or more R^{Qs} substituents” designate the C₃-C₈-cycloalkyl of C₃-C₈-cycloalkyloxy.

Cyclic R^{k} substituents as used herein in the expression “cyclic Q^{S} and R^{k} substituents may be substituted with one or more R^{Qs} substituents” designate C₃-C₈-cycloalkyl.

When R² and R⁴ are said herein to form together a covalent bond, the following group is obtained: —CR³═CR⁵—.

In the above formula (I), n is 0 or 1 and m is 0 or 1, provided that m is 1 when n is 1. Hence, the present invention relates to compounds wherein n is 1 and m is 1, or n is 0 and m is 1, or n is 0 and m is 0.

Processes for the Preparation of Compounds of Formula (I) and Intermediates

The present invention relates to processes for the preparation of compounds of formula (I) and their intermediates. Unless indicated otherwise, the radicals Q, T, R¹, R², R³, R⁴, R⁵, R⁶, R⁷, R⁸, m and n have the meanings given above for the compounds of formula (I). These definitions apply not only to the end products of formula (I) but also to all intermediates.

Compounds of formula (I-a)-(I-g) are various subsets of formula (I). Compounds of formula (I-a-1)-(I-a-8) are various subsets of formula (I-a). All substituents for formula (I-a)-(I-g) and (I-a-1)-(I-a-8) are as defined above for formula (I) unless otherwise noted.

The compounds of the general formula (I) can be prepared by various routes in analogy to known processes (see e.g. and references therein). Non-limiting examples of suitable processes are herein described.

A compound of formula (I) may be directly obtained by performing process A or B or may be obtained by conversion or derivatization of another compound of formula (I) prepared in accordance with the processes described herein. For instance, a compound of formula (I) can be converted into another compound of formula (I) by replacing one or more substituents of the starting compound of formula (I) by other substituents. Non-limiting examples of such conversion or derivatization are described below (processes C to H).

The processes described herein may be suitably performed using one or more inert organic solvents which is/are customary for the considered reaction. Suitable inert organic solvents can be chosen from the following: aliphatic, alicyclic or aromatic hydrocarbons (e.g. petroleum ether, pentane, hexane, heptane, cyclohexane, methylcyclohexane, ligroin, benzene, toluene, xylene or decalin), halogenated aliphatic, alicyclic or aromatic hydrocarbons (e.g. chlorobenzene, dichlorobenzene, dichloromethane, chloroform, carbon tetrachloride, 1,2-dichloroethane or trichloroethane), ethers (e.g. diethyl ether, diisopropyl ether, methyl t-butyl ether, methyl t-amyl ether, dioxane, tetrahydrofuran, 2-methyltetrahydrofuran, 1,2-dimethoxyethane, 1,2-diethoxyethane or anisole), ketones (e.g. acetone, methyl ethyl ketone, methyl isopropyl ketone and methyl isobutyl ketone), esters (e.g. methyl acetate, ethyl acetate or butyl acetate), alcohols (e.g. methanol, ethanol, propanol, iso-propanol, butanol, tert-butanol), nitriles (e.g. acetonitrile, propionitrile, n- or i-butyronitrile or benzonitrile), amides (e.g. N,N-dimethylformamide, N,N-dimethylacetamide, N-methylformanilide, N-methylpyrrolidone, or hexamethylphosphoric triamide), sulfoxides (e.g. dimethyl sulfoxide) or sulfones (e.g. sulfolane), ureas (e.g. 1,3-dimethyl-3,4,5,6-tetrahydro-2(1H)-pyrimidinone) or any mixture thereof.

Some processes described herein may require or be optionally performed using one or more inorganic or organic bases which are customary for such reactions. Examples of suitable inorganic and organic bases include, but are not limited to, alkaline earth metal or alkali metal carbonates (e.g. sodium carbonate, potassium carbonate, potassium bicarbonate, sodium bicarbonate or cesium carbonate), alkali metal hydrides (e.g. sodium hydride), alkaline earth metal or alkali metal hydroxides (e.g. sodium hydroxide, calcium hydroxide, potassium hydroxide or other ammonium hydroxide derivatives), alkaline earth metal, alkali metal or ammonium fluorides (e.g. potassium fluoride, cesium fluoride or tetrabutylammonium fluoride), alkali metal or alkaline earth metal acetates (e.g. sodium acetate, lithium acetate, potassium acetate or calcium acetate), alkali metal alcoholates (e.g. potassium tert-butoxide or sodium tert-butoxide), alkali metal phosphates (e.g. tri-potassium phosphate), tertiary amines (e.g. trimethylamine, triethylamine, tributylamine, N,N-dimethylaniline, N,N-dicyclohexylmethylamine, N,N-diisopropylethylamine, N-methylpiperidine, N,N-dimethylaminopyridine, diazabicyclooctane (DABCO), diazabicyclononene (DBN), diazabicycloundecene (DBU), quinuclidine, 3-acetoxyquinuclidine, guanidines or aromatic bases (e.g. pyridines, picolines, lutidines or collidines).

Some of the processes described herein may be optionally performed in the presence of a transition metal catalyst, such as a metal (e.g. copper or palladium) salt or complex, if appropriate in the presence of a ligand.

Suitable copper salts or complexes and their hydrates include, but are not limited to, copper metal, copper(I) iodide, copper(I) chloride, copper(I) bromide, copper(II) chloride, copper(II) bromide, copper(II) oxide, copper(I) oxide, copper(II) acetate, copper(I) acetate, copper(I) thiophene-2-carboxylate, copper(I) cyanide, copper(II) sulfate, copper(II) bis(2,2,6,6-tetramethyl-3,5-heptanedionate), copper(II) trifluoromethanesulfonate, tetrakis(acetonitrile)copper(I) hexafluorophosphate, tetrakis(acetonitrile)-copper(I) tetrafluoroborate.

It is also possible to generate in situ a suitable copper complex in the reaction mixture by separate addition to the reaction of a copper salt and a ligand or salt, such as ethylenediamine, N,N-dimethylethylenediamine, N,N′-dimethylethylenediamine, rac-trans-1,2-diaminocyclohexane, rac-trans-N,N′-dimethylcyclohexane-1,2-diamine, 1,1′-binaphthyl-2,2′-diamine, N,N,N′,N′-tetramethylethylenediamine, proline, N,N-dimethylglycine, quinolin-8-ol, pyridine, 2-aminopyridine, 4-(dimethyl-amino)pyridine, 2,2′-bipyridyl, 2,6-di(2-pyridyl)pyridine, 2-picolinic acid, 2-(dimethylaminomethyl)-3-hydroxypyridine, 1,10-phenanthroline, 3,4,7,8-tetramethyl-1,10-phenanthroline, 2,9-dimethyl-1,10-phenanthroline, 4,7-dimethoxy-1,10-phenanthroline, N,N′-bis[(E)-pyridin-2-ylmethylidene]cyclohexane-1,2-diamine, N-[(E)-phenylmethylidene], N-[(E)-phenylmethylidene]-cyclohexanamine, 1,1,1-tris(hydroxymethyl)ethane, ethylene glycol, 2,2,6,6-tetramethylheptane-3,5-dione, 2-(2,2-dimethylpropanoyl)cyclohexanone, acetylacetone, dibenzoylmethane, 2-(2-methyl-propanoyl)cyclohexanone, biphenyl-2-yl(di-tert-butyl)phosphane, ethylenebis-(diphenylphosphine), N,N-diethylsalicylamide, 2-hydroxybenzaldehyde oxime, oxo[(2,4,6-trimethylphenyl)amino]acetic acid or 1H-pyrrole-2-carboxylic acid.

Suitable palladium salts or complexes include, but are not limited to, palladium chloride, palladium acetate, tetrakis(triphenylphosphine)palladium(0), bis(dibenzylideneacetone)palladium(0), tris(di-benzylideneacetone)dipalladium(0), bis(triphenylphosphine)palladium(II) dichloride, [1,1′-bis(diphenyl-phosphino)ferrocene]dichloropalladium(II), bis(cinnamyl)dichlorodipalladium(II), bis(allyl)-dichloro-dipalladium(II) or [1,1′-Bis(di-tert-butylphosphino)ferrocene]dichloropalladium(II).

It is also possible to generate a palladium complex in the reaction mixture by separate addition to the reaction of a palladium salt and a ligand or salt, such as triethylphosphine, tri-tert-butylphosphine, tri-tert-butylphosphonium tetrafluoroborate, tricyclohexylphosphine, 2-(dicyclohexylphosphino)biphenyl, 2-(di-tert-butylphosphino)biphenyl, 2-(dicyclohexylphosphino)-2′-(N,N-dimethylamino)biphenyl, 2-(tert-butylphosphino)-2′-(N,N-dimethylamino)biphenyl, 2-di-tert-butylphosphino-2′,4′,6′-triisopropylbiphenyl, 2-dicyclohexylphosphino-2′,4′,6′-triisopropylbiphenyl, 2-dicyclohexylphosphino-2,6′-dimethoxybiphenyl, 2-dicyclohexylphosphino-2′,6′-diisopropoxybiphenyl, triphenyl-phosphine, tris-(o-tolyl)phosphine, sodium 3-(diphenylphosphino)benzenesulfonate, tris-(2-methoxy-phenyl)phosphine, 2,2′-bis(diphenylphosphino)-1,1′-binaphthyl, 1,4-bis(diphenylphosphino)butane, 1,2-bis(diphenyl-phosphino) ethane, 1,4-bis(dicyclohexylphosphino)butane, 1,2-bis(dicyclohexylphosphino)-ethane, 2-(dicyclohexylphosphino)-2′-(N,N-dimethylamino)-biphenyl, 1,1′-bis(diphenylphosphino)-ferrocene, (R)-(−)-1-[(S)-2-diphenylphosphino)ferrocenyl]ethyldicyclohexylphosphine, tris-(2,4-tert-butyl-phenyl)phosphite, di(1-adamantyl)-2-morpholinophenylphosphine or 1,3-bis(2,4,6-trimethylphenyl)imidazolium chloride.

The appropriate catalyst and/or ligand may be chosen from commercial catalogues such as “Metal Catalysts for Organic Synthesis” by Strem Chemicals or from reviews (Chemical Society Reviews (2014), 43, 3525, Coordination Chemistry Reviews (2004), 248, 2337 and references therein).

Some of the processes described herein may be performed by metallo-photoredox catalysis according to methods reported in the literature (Nature chemistry review, (2017) 0052 and references therein; Science (2016) 352, 6291, 1304; Org. Lett. 2016, 18, 4012, J. Org. Chem 2016, 81, 6898; J. Am. Chem. Soc. 2016, 138, 12715, J. Am. Chem. Soc. 2016, 138, 13862; J. Am. Chem. Soc. 2016, 138, 8034; J. Org. Chem. 2016, 81, 12525, J. Org. Chem. 2015, 80, 7642). The process is then performed in the presence a photosensitizer, such as Ir and Ru complexes or organic dyes, and a metal catalyst such as Ni complexes.

The reaction can be performed in the presence of a ligand and if appropriate in the presence of a base under irradiation with blue or white light.

Suitable photosensitizers include, but are not limited to, Ir(III) photocatalyst such as [Ir(dFCF₃ppy)₂(bpy)]PF₆ (dFCF₃ppy=2-(2,4-difluorophenyl)-5-trifluoromethylpyridine, bpy=2,2′-bipyridine), [Ir(dFCF₃ppy)₂(dtbbpy)]PF₆ (dtbbpy=4,4′-di-tert-butyl-2,2′-bipyridine), Ir(ppy)₂(dtbbpy)PF₆ (ppy=2-phenylpyridine), Ir(ppy)₂(bpy)PF₆, Ir(dFppy)₃PF₆ (dFCF₃ppy=2-(2,4-difluorophenyl)pyridine), fac-Ir(ppy)₃, (Ir[diF(5-Me)ppy]₂(tetraMePhen)PF₆ (diF(5-Me)ppy=2-(2,4-difluorophenyl)-5-methylpyridine, tetraMePhen=3,4,7,8-tetramethyl-1,10-phenanthroline), Ru(II) photocatalyst such as Ru(bpy)₃Cl₂ or Ru(bpy)₃(PF₆)₂ or organic dyes like 9-mesityl-10-acridinium, salts like perchlorate or tetrafluoroborate, or 2,4,5,6-tetra-9H-carbazol-9-yl-1,3-benzenedicarbonitrile, 9-fluorenone and 9,10-phenanthrenequinone.

Suitable nickel catalysts include, but are not limited to, bis(1,5-cyclooctadiene)nickel (0), nickel(II) chloride, nickel(II) bromide, nickel(II) iodide under their anhydrous or hydrate forms or as dimethoxyethane complexes, nickel(II) acetylacetonate, nickel(II) nitrate hexahydrate. These nickel catalysts can be used in combination with bipyridine ligand such as 2,2′-bipyridine, 4,4′-di-tert-butyl-2,2′-bipyridine, 4,4′-dimethoxy-2,2′-bipyridine, 4,4′-dimethyl-2,2′-bipyridine or phenantroline such as 1,10-phenanthroline, 4,7-dimethyl-1,10-phenantroline, 4,7-dimethoxy-1,10-phenantroline or diamines such as N,N,N′,N′-tetramethylethylenediamine or dione such as tetramethylheptanedione.

The processes described herein may be performed at temperatures ranging from −105° C. to 250° C., preferably from −78° C. to 185° C.

The reaction time varies as a function of the scale of the reaction and of the reaction temperature, but is generally between a few minutes and 48 hours.

The processes described herein are generally performed under standard pressure. However, it is also possible to work under elevated or reduced pressure.

In the processes described herein, the starting materials are generally used in approximately equimolar amounts. However, it is also possible to use one of the starting materials in a relatively large excess.

Processes for the Preparation of Compounds of Formula (I)

Process A

A compound of formula (I-a) (i.e. formula (I) wherein T is O and R¹ is a defined in scheme 1) can be prepared by a process comprising the step of reacting a compound of formula (1) with an amine of formula (2) or one of its salts as shown in scheme 1.

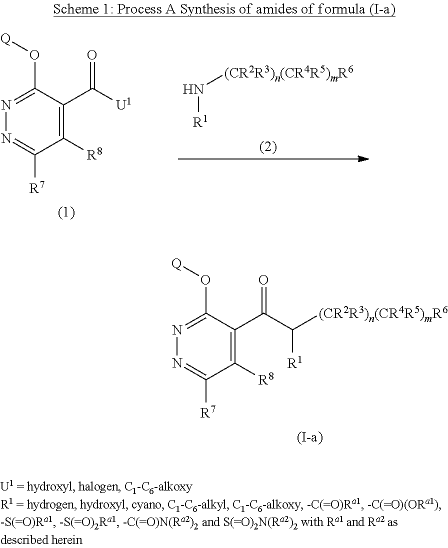

Compounds of formula (1) wherein U¹ is a hydroxyl group can be reacted with an amine of formula (2) in the presence of a condensing reagent by means of methods described in the literature (e.g. Tetrahedron 2005, 61, 10827-10852). Examples of suitable condensing reagents include, but are not limited to, halogenating reagents (e.g. phosgene, phosphorous tribromide, phosphorous trichloride, phosphorous pentachloride, phosphorous trichloride oxide, oxalyl chloride or thionyl chloride), dehydrating reagents (e.g. ethyl chloroformate, methyl chloroformate, isopropyl chloroformate, isobutyl chloroformate or methanesulfonyl chloride), carbodiimides (e.g. N,N′-dicyclohexylcarbodiimide (DCC)) or other customary condensing (or peptide coupling) reagents (e.g. phosphorous pentoxide, polyphosphoric acid, bis(2-oxo-3-oxazolidinyl)phosphinic chloride, 1-[Bis(dimethylamino)methylene]-1H-1,2,3-triazolo[4,5-b]pyridinium 3-oxid hexafluorophosphate (HATU), N,N′-carbonyl-diimidazole, 2-ethoxy-N-ethoxycarbonyl-1,2-dihydroquinoline (EEDQ), triphenylphosphine/tetrachloro-methane, 4-(4,6-dimethoxy[1.3.5]-triazin-2-yl)-4-methylmorpholinium chloride hydrate, bromo-tripyrrolidinophosphoniumhexafluorophosphate or propanephosphonic anhydride (T3P).

Compounds of formula (1) wherein U¹ is a halogen atom can be reacted with an amine of formula (2) in the presence of an acid scavenger by means of well-known methods. Suitable acid scavengers include any inorganic and organic bases, as described herein, which are customary for such reactions. Preference is given to alkali metal carbonates, alkaline earth metal acetates, tertiary amines or aromatic bases.

Compounds of formula (1) wherein U¹ is a C₁-C₆-alkoxy group can be reacted with an excess of amine of formula (2), optionally in the presence of a Lewis acid such as trimethylaluminum.

Compounds of formula (1) can be prepared by one or more of the processes described herein (see processes I, J and K).

Amines of formula (2) are either commercially available or may be prepared in accordance with processes described in the literature (e.g. WO2007141009, WO2013064460, WO2015078800, WO2016066574, US20060116370, WO2007134799, WO2014177487, WO2011144338, EP0807629).

Process B

A compound of formula (I-a-1) (i.e. formula (I) wherein T is O, R¹ is hydrogen, cyano, hydroxyl, C₁-C₆-alkyl or C₁-C₆-alkoxy, R⁷ and R⁸ are as defined in scheme 2) can be prepared by a process comprising the step of reacting a compound of formula (3) and a compound of formula (4) in the presence of a base (e.g. organic or inorganic base) as shown in scheme 2.

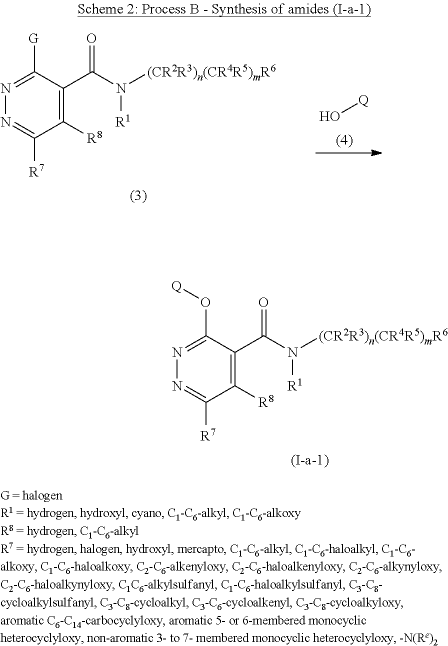

In scheme 2, R^{e} is as disclosed herein and R⁷, R⁸ and R^{e} may be substituted as disclosed herein.

Process B may be performed in the presence of a transition metal catalyst, such as a copper salt or complex, if appropriate in the presence of a ligand.

Compounds of formula (3) can be prepared by process L described herein.

Compounds of formula (4) are commercially available or may be obtained by conversion or derivatization of another compound of formula (4) in accordance to well-known methods.

Process C

A compound of formula (I-b) (i.e. formula (I) wherein T is S and R¹ is hydrogen) can be prepared by a process comprising the step of reacting a compound of formula (I-a-2) (i.e. formula (I) wherein T is O and R¹ is hydrogen) with a thionating agent as shown in scheme 3.

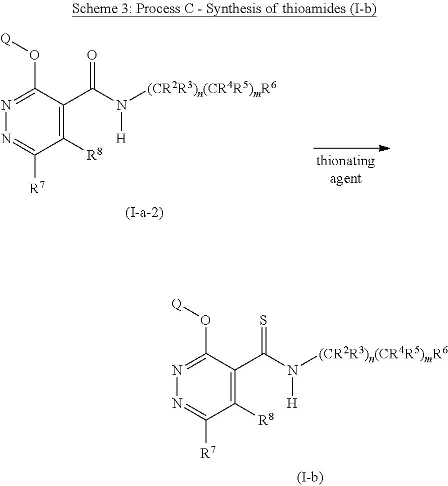

Suitable thionating agents for carrying out process C include, but are not limited to, sulfur (S), sulfhydric acid (H₂S), sodium sulfide (Na₂S), sodium hydrosulfide (NaHS), boron trisulfide (B₂S₃), bis(diethylaluminium) sulfide ((AlEt₂)₂S), ammonium sulfide ((NH₄)₂S), phosphorous pentasulfide (P₂S₅), Lawesson's reagent (2,4-bis(4-methoxyphenyl)-1,2,3,4-dithiadiphosphetane 2,4-disulfide) or a polymer-supported thionating reagent such as described in Journal of the Chemical Society, Perkin 1 (2001), 358.

The process is optionally performed in the presence of a catalytic or stoichiometric or excess amount of a base (inorganic and organic base). Preference is given to alkali metal carbonates (e.g. sodium carbonate, potassium carbonate, potassium bicarbonate, sodium bicarbonate), heterocyclic aromatic bases (e.g. pyridine, picoline, lutidine, collidine) and also tertiary amines (e.g. trimethylamine, triethylamine, tributylamine, N,N-dimethylaniline, N,N-dimethylpyridin-4-amine or N-methyl-piperidine).

A compound of formula (I-a-2) can be prepared by one or more of the processes herein described.

Process D

A compound of formula (I-c) (i.e. formula (I) wherein R¹ is —C(═O)R^{a1}, —C(═O)(OR^{a1}), with R^{a1} being as described herein) can be prepared by a process comprising the step of reacting a compound of formula (I-a-2) formula (i.e. formula (I) wherein T is O and R¹ is hydrogen) or a compound of formula (I-b) (i.e. formula (I) wherein T is S and R¹ is hydrogen) with a compound of formula (5) as shown in scheme 4.

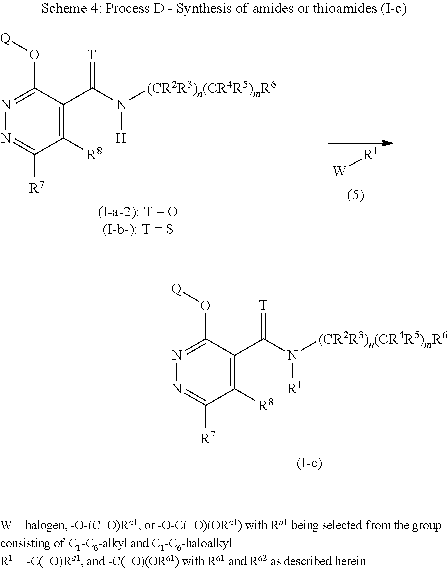

Process D can be performed by means of methods described in the literature (e.g. Tetrahedron Lett. 1995, 36, 8949; Greene's Protective Groups in organic Synthesis; Peter G. M. Wuts; Wiley; Fifth Edition; 2014; 1174-1175).

Compounds of formula (5) are commercially available.

Compounds of formula (I-a-2) or (I-b) can be prepared by one or more of the processes herein described.

Process E

A compound of formula (I-a-3) (i.e. formula (I) wherein R¹ is H, T is O, R⁷ is R^{7a} as shown in scheme 5) can be converted by means of methods described in the literature to the corresponding compounds (I-a-4) (i.e. formula (I) wherein R¹ is H, T is O, R⁷ is R^{7b} as shown in scheme 5) or (I-a-5) (i.e. formula (I) wherein R¹ is H, T is O, R⁷ is R^{7c} as shown in scheme 5) in one or more steps as shown in scheme 5.

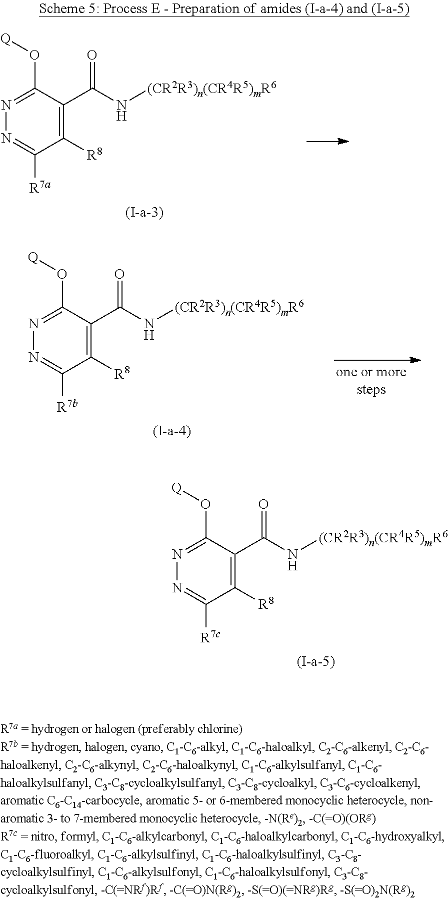

In scheme 5, R^{e}, R^{f}, R^{g} are as disclosed herein and the aliphatic and cyclic substituents R^{7b}, R^{7c}, R^{e}, R^{f}, R^{g} may be substituted as disclosed herein.

Non-limiting examples of conversions performed in accordance with scheme 5 are provided below.

A compound of formula (I-a-3) wherein R^{7a} is a chlorine atom can be converted into a compound of formula (I-a-4) wherein R^{7b} is a bromine or an iodine atom by means of methods described in the literature (e.g. WO2016185342, WO2007022937).

A compound of formula (I-a-3) wherein R^{7a} is a halogen atom can be converted into a compound of formula (I-a-4) wherein R^{7b} is a hydrogen atom in the presence of a palladium catalyst as reported in the literature (Journal of Molecular Catalysis A: Chemical, 2014, 393, 191-209).

A compound of formula (I-a-3) wherein R^{7a} is a hydrogen atom or a halogen atom can be converted into a compound of formula (I-a-4) wherein R^{7b} is cyano, C₁-C₆-alkyl, C₁-C₆-haloalkyl, C₂-C₆-alkenyl, C₂-C₆-haloalkenyl, C₂-C₆-alkynyl, C₂-C₆-haloalkynyl, C₁-C₆-alkylsulfanyl, C₁-C₆-haloalkylsulfanyl, C₃-C₈-cycloalkyl, C₃-C₆-cycloalkenyl, aromatic C₆-C₁₄-carbocycle, aromatic 5- or 6-membered monocyclic heterocycle, non-aromatic 3- to 7-membered monocyclic heterocycle, —N(R^{e})₂ or —C(═O)(OR^{g}) by transition metal catalyzed or metallo-photoredox catalyzed processes as described herein.

A compound of formula (I-a-4) wherein R^{7b} is a C₂-C₆-alkenyl group substituted by a C₁-C₃-alkoxy can be converted into a compound of formula (I-a-5) wherein R^{7c} is a C₁-C₆-alkylcarbonyl group by means of methods described in the literature (e.g. J. Org. Chem. 1993, 55, 3114).

The compound of formula (I-a-5) wherein R^{7c} is a C₁-C₆-alkylcarbonyl group can be further converted in a compound of formula (I-a-5) wherein R^{7c} is —C(═NR^{f})—C₁-C₆-alkyl group by methods described in the literature (e.g. Greene's Protective Groups in organic Synthesis; Peter G. M. Wuts; Wiley; Fifth Edition; 2014; 655, 661, 667).

A compound of formula (I-a-5) wherein R^{7c} is a C₁-C₆-alkylcarbonyl group can be further converted in a compound of formula (I-a-5) wherein R^{7c} is C₁-C₆-hydroxyalkyl group by classical functional group interconversion such as reductions of ketones to alcohols in the presence of NaBH₄ in MeOH.

A compound of formula (I-a-5) wherein R^{7c} is C₁-C₆-hydroxyalkyl group can be further converted into a compound (I-a-5) wherein R^{7c} is C₁-C₆-fluoroalkyl in the presence of a fluorinating agent. Non-limitative examples of fluorinating agents include sulfur fluorides such as sulfur tetrafluoride, diethylaminosulfurtrifluoride, morpholinosulfur trifluoride, bis(2-methoxyethyl)aminosulfur trifluoride, 2,2-difluoro-1,3-dimethylimidazolidine or 4-tert-butyl-2,6-dimethylphenylsulfur trifluoride.

A compound of formula (I-a-3) can be prepared by one or more of the processes herein described.

Process F

A compound of formula (I-a-6) (i.e. formula (I) wherein R¹ is H, T is O, R⁷ is halogen and R⁸ is hydrogen) can be converted by means of methods described in the literature to the corresponding compound of formula (I-a-7) (i.e. formula (I) wherein R¹ is H, T is O, R⁷ is halogen and R⁸ is R^{8a} as shown in scheme 6) or compound of formula (I-a-8) (i.e. formula (I) wherein R¹ is H, T is O, R⁷ is halogen and R⁸ is R^{8b} as shown in scheme 6) in one or more steps as shown in scheme 6.

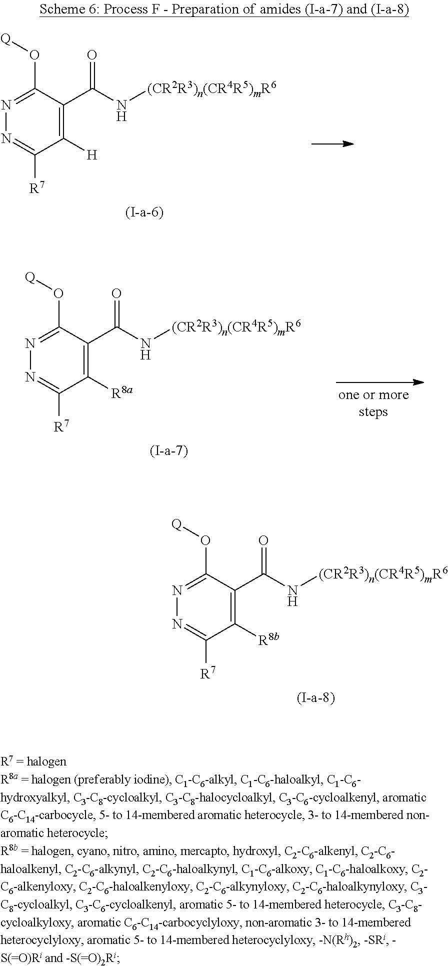

In scheme 6, R^{h} and Rⁱ are as disclosed herein and the aliphatic and cyclic substituents R^{8a} and R^{8b} may be substituted as disclosed herein.

Non-limiting examples of conversions performed in accordance with scheme 6 are provided below.

A compound of formula (I-a-6) can be converted into a compound of formula (I-a-7) wherein R^{8a} is a halogen atom in the presence of a base and an electrophile such as NCS, NBS, NIS, hexachloroethane, bromine or iodine by means of methods described in the literature (e.g. Org. Lett. 2009, 11, 1837). Suitable bases for carrying out the process can be selected from lithium-diisopropylamide, lithium 2,2,6,6-tetramethylpiperidide, n-butyl lithium, methyl lithium, TMPZnCl.LiCl (2,2,6,6-tetramethylpiperidinylzinc chloride lithium chloride complex), TMP₂Zn.2MgCl₂. 2LiCl (bis(2,2,6,6-tetramethylpiperidinyl)zinc magnesium chloride lithium chloride complex), see e.g. Dissertation Albrecht Metzer 2010, University Munich.

A compound of formula (I-a-6) can be converted into a compound of formula (I-a-7) wherein R^{8a} is a C₁-C₆-alkyl, C₁-C₆-haloalkyl, C₁-C₆-hydroxyalkyl, C₃-C₈-cycloalkyl, C₃-C₈-halocycloalkyl, C₃-C₆-cycloalkenyl, aromatic C₆-C₁₄-carbocycle, 5- to 14-membered aromatic heterocycle or a 3- to 14-membered non-aromatic heterocycle, optionally in the presence of a base, and when appropriate in the presence of a transition metal catalyst such as a metal salt or complex and a ligand as described herein or by methods described in the literature (Heterocycles 1976, 4(8), 1331).

A compound of formula (I-a-7) wherein R^{8a} is a halogen atom can be converted in a compound of formula (I-a-8) wherein R^{8b} represents cyano, nitro, amino, mercapto, hydroxyl, C₂-C₆-alkenyl, C₂-C₆-haloalkenyl, C₂-C₆-alkynyl, C₂-C₆-haloalkynyl, C₁-C₆-alkoxy, C₁-C₆-haloalkoxy, C₂-C₆-alkenyloxy, C₂-C₆-haloalkenyloxy, C₃-C₈-cycloalkyl, C₃-C₆-cycloalkenyl, aromatic 5- to 14-membered heterocycle, C₃-C₈-cycloalkyloxy, aromatic C₆-C₁₄-carbocyclyloxy, non-aromatic 3- to 14-membered heterocyclyloxy, aromatic 5- to 14-membered heterocyclyloxy, —N(R^{h})₂ or SRⁱ in the presence of a base and optionally in the presence of a transition metal catalyst such as a metal salt or complex, and if appropriate in the presence of a ligand.

A compound of formula (I-a-8) wherein R^{8b} is a C₂-C₆-alkenyl group can be further converted in a compound of formula (I-a-8) wherein R^{8b} is C₁-C₆-alkyl substituted by C₁-C₆-alkoxy, C₁-C₆-haloalkoxy, C₁-C₆-alkoxy-C₁-C₆-alkoxy, C₁-C₆-alkylsulfanyl, C₁-C₆-haloalkylsulfanyl, non-aromatic 3- to 7-membered monocyclic heterocycle and —N(R^{a′})₂ with R^{a′} being independently selected from the group consisting of hydrogen, C₁-C₆-alkyl, C₁-C₆-haloalkyl and C₃-C₈-cycloalkyl, by treating the reacting compound of formula (I-a-8) with an oxygen, a sulfur or an amino based nucleophile.

A compound of formula (I-a-8) wherein R^{8b} is a SRⁱ group can be further converted in a compound of formula (I-a-8) wherein R^{8b} is a —S(═O)Rⁱ, or a —S(═O)₂Rⁱ group by reacting the starting compound of formula (I-a-8) with an oxidant such as hydrogen peroxide.

A compound of formula (I-a-6) can be prepared by one or more of the processes herein described.

Process G

A compound of formula (I-d) (i.e. formula (I) wherein R^{6S} is halogen) or a compound of formula (6) can be reacted with a compound of formula (7) to provide a compound of formula (I-e) (i.e. formula (I) wherein R^{6S} is as shown in scheme 7) as shown in scheme 7.

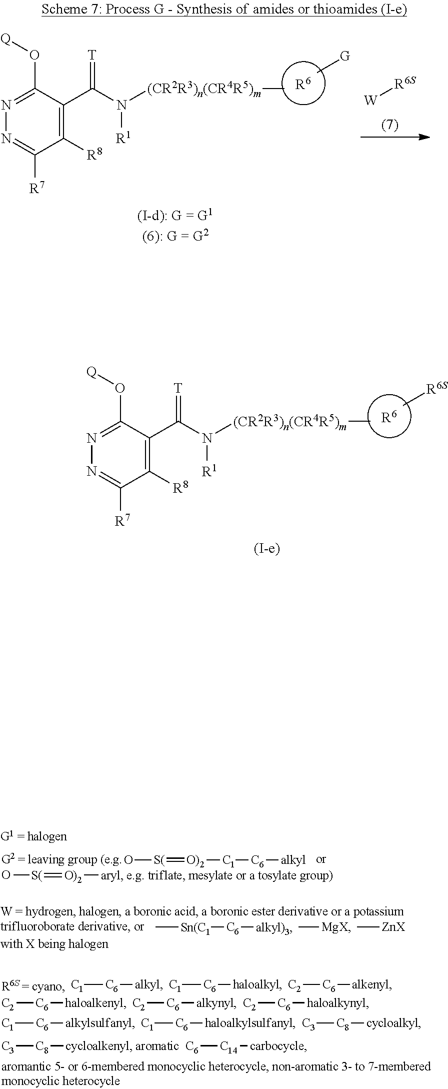

In scheme 7, aliphatic and cyclic R^{6S} substituents may be substituted as disclosed herein.

Process G can be performed by metal catalysis as described herein.

Alternatively, process G can be performed by metallo-photoredox catalysis. More specifically, a compound of formula (I-d), wherein G¹ is preferably Br or I, can be converted to a compound of formula (I-e) by a metallo-photoredox catalysed process in the presence a photosensitizer such as Ir and Ru complexes or organic dyes and metal catalysts such as Ni complexes. The reaction can be performed in the presence of a ligand and if appropriate in the presence of a base under irradiation with blue or white light.

A compound of formula (I-d) can be prepared by one or more of the processes herein described.

A compound of formula (6) can be prepared by well-known methods.

Compounds of formula (7) are commercially available.

Process H

A compound of formula (I-f) (i.e. formula (I) wherein Q^{S} is halogen) or a compound of formula 8 can be reacted with a compound of formula 9 to provide a compound of formula (I-g) (i.e. formula (I) wherein Q^{S} is as shown in scheme 8) as shown in scheme 8.

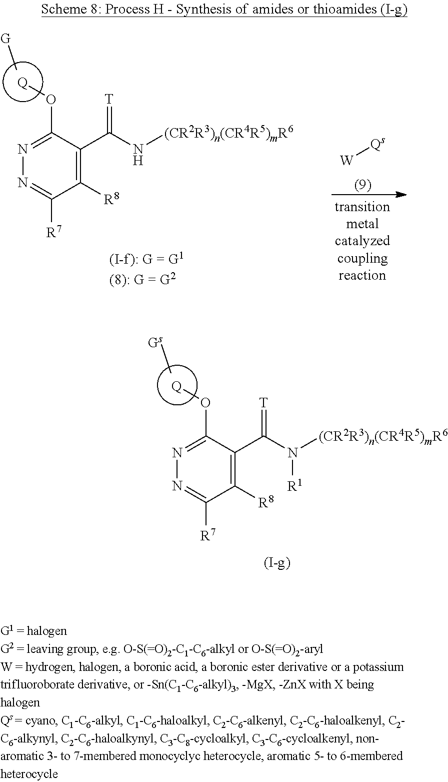

In scheme 8, aliphatic and cyclic Q^{S} substituents may be substituted as disclosed herein.

Process H can be performed by transition metal catalysis.

Alternatively, process H can be performed by metallo-photoredox catalysis. More specifically, a compound of formula (I-f), wherein G¹ is preferably Br or I, can be converted to a compound of formula (I-g) by a metallo-photoredox catalysed process in the presence a photosensitizer such as Ir and Ru complexes or organic dyes and metal catalysts such as Ni complexes. The reaction can be performed in the presence of a ligand and if appropriate in the presence of a base under irradiation with blue or white light.

A compound of formula (I-f) can be prepared by one or more of the processes herein described.

A compound of formula (8) can be prepared by well-known methods.

Compounds of formula (9) are commercially available.

Processes for the Preparation of a Compound of Formula (1)

A compound of formula (1) may be directly obtained by performing process I described below or may be obtained by conversion or derivatization of another compound of formula (1) prepared in accordance with the processes described herein. Compounds of formula (1-a)-(1-h) are various subsets of formula (1).

Process I

A compound of formula (1-a) (i.e. formula (1) wherein R⁷ and R⁸ are as defined in scheme 9) can be prepared by a process comprising the step of reacting a compound of formula (10) with a reagent of formula (4) in the presence of a base as shown in scheme 9.

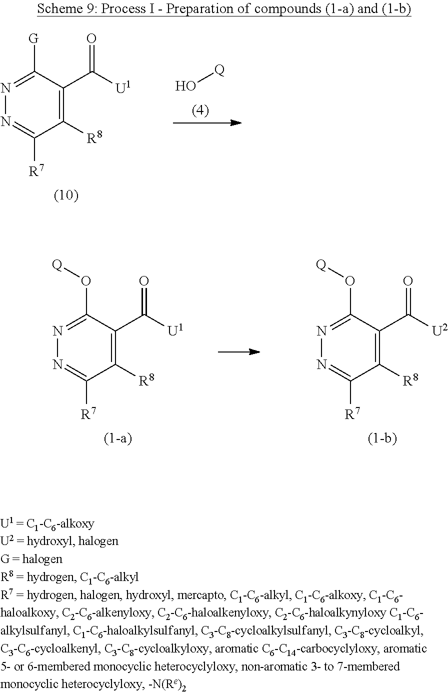

In scheme 9, R^{e} is as disclosed herein and R⁷, R⁸ and R^{e} may be substituted as disclosed herein.

Process I can be performed in the presence of suitable transition metal catalyst salts or complexes, if appropriate in the presence of a ligand.

The obtained compound of formula (1-a) can then be converted into a compound of formula (1-b) in one or more steps.

Non-limiting examples of such conversion are described below.

Compounds of formula (1-a) wherein U¹ is a C₁-C₆-alkoxy can be converted to compounds of formula (1-b) wherein U² is a hydroxyl group by well-known functional group interconversion methods, for example by hydrolysis of an ester group with LiOH in THF/water.

Compounds of formula (1-b) wherein U² is a hydroxyl can be converted to compounds of formula (1-b) wherein U² is a halogen in the presence of halogenating agents by well-known methods. Suitable halogenating reagents include, but are not limited to, phosphorous tribromide, phosphorous trichloride, phosphorous pentachloride, phosphorous trichloride oxide, oxalyl chloride or thionyl chloride.

Compounds of formula (10) are commercially available or may be prepared by process M described herein.

Compounds of formula (4) are commercially available or may be obtained by conversion or derivatization of another compound of formula (4) in accordance to well-known methods.

Process J

A compound of formula (1-c) (i.e. formula (1) wherein R⁷ is R^{7a} as defined in scheme 10) can be converted by means of know methods to the corresponding compounds of formula (1-d) (i.e. formula (1) wherein R⁷ is R^{7b} as defined in scheme 10) or (1-e) (i.e. formula (1) wherein R⁷ is R^{7c} as defined in scheme 10) in one or more steps as shown in scheme 10.

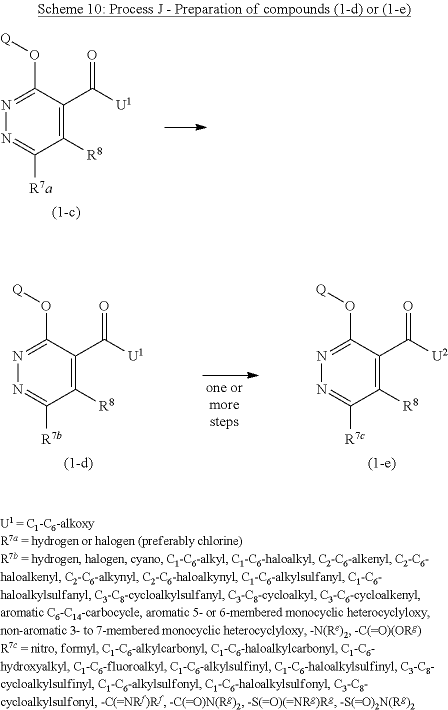

In scheme 10, R^{e}, R^{f}, R^{g} are as disclosed herein and the aliphatic and cyclic substituents R^{7b}, R^{7c}, R^{e}, R^{f}, R^{g} may be substituted as disclosed herein.

Non-limiting examples of conversion may be performed in accordance to the description provided in process E.

Compounds of formula (1-c), (1-d), (1-e) wherein U¹ is a C₁-C₆-alkoxy can be converted to compounds of formula (1-c), (1-d), (1-e) wherein U¹ is a hydroxyl group by well-known functional group interconversion methods. For example by hydrolysis of an ester group with LiOH in THF/water.

Compounds of formula (1-c), (1-d), (1-e) wherein U¹ is hydroxyl can then be further converted to compounds of formula (1-c), (1-d), (1-e) wherein U¹ is a halogen in the presence of halogenating agents using well-known methods. Suitable halogenating reagents include, but are not limited to, phosphorous tribromide, phosphorous trichloride, phosphorous pentachloride, phosphorous trichloride oxide, oxalyl chloride or thionyl chloride.

Compounds of formula (1-c) can be prepared by one or more of the processes described herein.

Process K

A compound of formula (1-f) (i.e. formula (1) wherein R⁸ is H) can be converted by means of methods described in the literature to the corresponding compound of formula (1-g) (i.e. formula (1) wherein R⁸ is R^{8a} as defined in scheme 11) or compound of formula (1-h) (i.e. formula (1) wherein R⁸ is R^{8b} as defined in scheme 11) in one or more steps as shown in scheme 11.

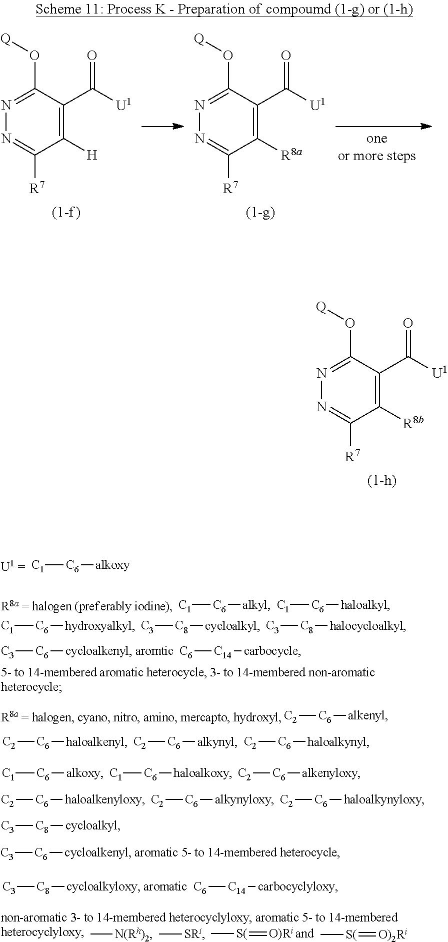

In scheme 11, R^{h} and Rⁱ are as disclosed herein and the aliphatic and cyclic substituents R^{8a} and R^{8h} may be substituted as disclosed herein.

Non-limiting examples of conversion may be performed in accordance to the description provided in process F.

Compounds of formula (1-f), (1-g), (1-h) wherein U¹ is a C₁-C₆-alkoxy can be converted to compounds of formula (1-f), (1-g), (1-h) wherein U¹ is a hydroxyl group by well-known functional group interconversion methods, for example by hydrolysis of an ester group with LiOH in THF/water.

Compounds of formula (1-f), (1-g), (1-h) wherein U¹ is a hydroxyl can then be further converted to compounds of formula (1-f), (1-g), (1-h) wherein U¹ is a halogen in the presence of halogenating agents using well-known methods. Suitable halogenating reagents include, but are not limited to, phosphorous tribromide, phosphorous trichloride, phosphorous pentachloride, phosphorous trichloride oxide, oxalyl chloride or thionyl chloride.

Compounds (1-f) can be prepared by one or more of the processes described herein.

Process for the Preparation of Compound of Formula (3)

Process L

A compound of formula (3) can be prepared by a process comprising the step of reacting a compound of formula (10) with an amine of formula (2) or one of its salts as shown in scheme 12.

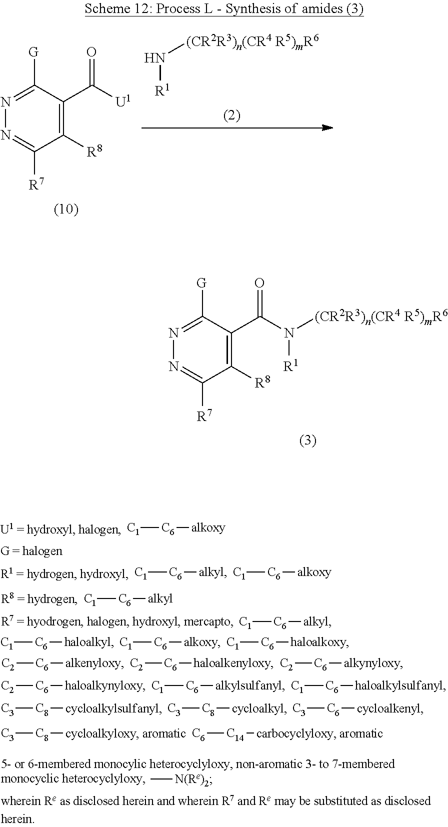

Process L can be performed using the same conditions described in process A.

Compounds of formula (10) are commercially available or can be obtained by process M.

Process for the Preparation of Compound of Formula (10)

Process M

A compound of formula (10-a) (i.e. compound of formula 10 wherein R⁷ is halogen) can be converted by means of known methods (WO2000044755) into a compound of formula (10-b) (i.e. compound of formula wherein R⁷ is as shown in scheme 13) in the presence of either an oxygen (ethanol), a sulfur (thioethyl) or an amino (methylamine) based nucleophile, optionally in the presence of base as shown in scheme 13.

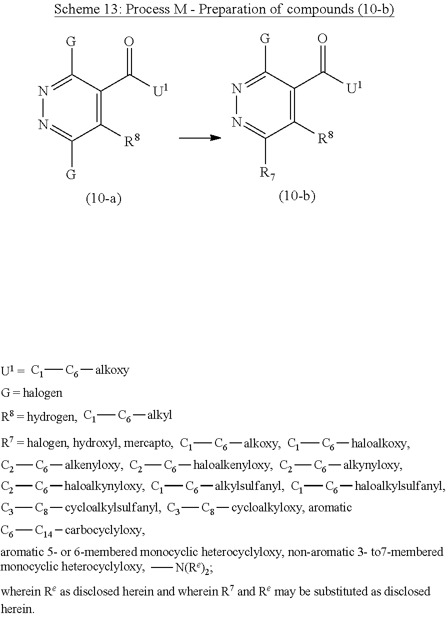

The compounds of formula (10-a) and (10-b) can be converted into compound of formula (10-a) and (10-b) wherein U¹ (C₁-C₆-alkoxy) is replaced with hydroxyl or halogen using the same conditions as described in process K.

Starting materials of formula (10-a) are commercially available.

Compounds according to the invention can be prepared according to the above described processes. It will nevertheless be understood that, on the basis of his general knowledge and of available publications, the skilled worker will be able to adapt these processes according to the specifics of each of the compounds according to the invention that is desired to be synthesized.

Compound (B)

The active compound combinations according to the invention comprise as compound (B) at least one further active compound selected from the following groups
(1) inhibitors of the ergosterol synthesis,
(2) inhibitors of the respiratory chain at complex I or II,
(3) inhibitors of the respiratory chain at complex III,
(4) inhibitors of the mitosis and cell division,
(5) compounds capable of having a multisite action,
(6) compounds capable of inducing a host defense,
(7) inhibitors of the amino acid and/or protein biosynthesis,
(8) inhibitors of the ATP production,
(9) inhibitors of the cell wall synthesis,
(10) inhibitors of the lipid and membrane synthesis,
(11) inhibitors of the melanine biosynthesis,
(12) inhibitors of the nucleic acid synthesis,
(13) inhibitors of the signal transduction,
(14) compounds capable of acting as uncoupler,
(15) other fungicides selected from the group consisting of (15.001) abscisic acid, (15.002) benthiazole, (15.003) bethoxazin, (15.004) capsimycin, (15.005) carvone, (15.006) chinomethionat, (15.007) cufraneb, (15.008) cyflufenamid, (15.009) cymoxanil, (15.010) cyprosulfamide, (15.011) flutianil, (15.012) fosetyl-aluminium, (15.013) fosetyl-calcium, (15.014) fosetyl-sodium, (15.015) methyl isothiocyanate, (15.016) metrafenone, (15.017) mildiomycin, (15.018) natamycin, (15.019) nickel dimethyldithiocarbamate, (15.020) nitrothal-isopropyl, (15.021) oxamocarb, (15.022) oxathiapiprolin, (15.023) oxyfenthiin, (15.024) pentachlorophenol and salts, (15.025) phosphorous acid and its salts, (15.026) propamocarb-fosetylate, (15.027) pyriofenone (chlazafenone), (15.028) tebufloquin, (15.029) tecloftalam, (15.030) tolnifanide, (15.031) 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.032) 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.033) 2-(6-benzylpyridin-2-yl)quinazoline, (15.034) dipymetitrone, (15.035) 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl)piperidin-1-yl]ethanone, (15.036) 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperidin-1-yl]ethanone, (15.037) 2-[3,5-bis(difluoromethyl)-1H-pyrazol-1-yl]-1-[4-(4-{5-[2-fluoro-6-(prop-2-yn-1-yloxy)phenyl]-4,5-dihydro-1,2-oxazol-3-yl}-1,3-thiazol-2-yl)peperidin-1-yl]ethanone, (15.038) 2-[6-(3-fluoro-4-methoxyphenyl)-5-methyl-pyridin-2-yl]quinazoline, (15.039) 2-{(5R)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.040) 2-{(5S)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.041) ipflufenoquin, (15.042) 2-{2-fluoro-6-[ (8-fluoro-2-methylquinolin-3-yl)oxy]phenyl}propan-2-ol, (15.043) fluoxapiprolin, (15.044) 2-{3-[2-(1-[3,5-bis(difluoromethyl)-1H-pyrazol-1-yl]acetyl}piperidin-4-yl)-1,3-thiazol-4-yl]-4,5-dihydro-1,2-oxazol-5 phenyl methanesulfonate, (15.045) 2-phenylphenol and salts, (15.046) 3-(4,4,5-trifluoro-3,3-dimethyl-3,4-dihydroisoquinolin-1-yl)quinoline, (15.047) quinofumelin, (15.048) 4-amino-5-fluoropyrimidin-2-ol (tautomeric form: 4-amino-5-fluoropyrimidin-2(1H)-one), (15.049) 4-oxo-4-[(2-phenylethyl)amino]butanoic acid, (15.050) 5-amino-1,3,4-thiadiazole-2-thiol, (15.051) 5-chloro-N′-phenyl-N′-(prop-2-yn-1-yl)thiophene-2-sulfonohydrazide, (15.052) 5-fluoro-2-[(4-fluorobenzyl)oxy]pyrimidin-4-amine, (15.053) 5-fluoro-2-[(4-methylbenzyl)oxy]pyrimidin-4-amine, (15.054) 9-fluoro-2,2-dimethyl-5-(quinolin-3-yl)-2,3-dihydro-1,4-benzoxazepine, (15.055) but-3-yn-1-yl {6-[({[(Z)-(1-methyl-1H-tetrazol-5-yl)(phenyl)methylene]amino}oxy)methyl]pyridin-2-yl}carbamate, (15.056) ethyl (2Z)-3-amino-2-cyano-3-phenylacrylate, (15.057) phenazine-1-carboxylic acid, (15.058) propyl 3,4,5-trihydroxybenzoate, (15.059) quinolin-8-ol, (15.060) quinolin-8-ol sulfate (2:1), (15.061) tert-butyl {6-[({[(1-methyl-1H-tetrazol-5-yl)(phenyl)methylene]amino}oxy)methyl]pyridin-2-yl}carbamate, (15.062) 5-fluoro-4-imino-3-methyl-1-[(4-methylphenyl)sulfonyl]-3,4-dihydropyrimidin-2(1H)-one, (15.063) aminopyrifen, (15.064) (N′-[2-chloro-4-(2-fluorophenoxy)-5-methylphenyl]-N-ethyl-N-methylimidoformamide), (15.065) (N′-(2-chloro-5-methyl-4-phenoxyphenyl)-N-ethyl-N-methylimidoformamide), (15.066) (2-{2-[(7,8-difluoro-2-methylquinolin-3-yl)oxy]-6-fluorophenyl}propan-2-ol), (15.067) (5-bromo-1-(5,6-dimethylpyridin-3-yl)-3,3-dimethyl-3,4-dihydroisoquinoline), (15.068) (3-(4,4-difluoro-5,5-dimethyl-4,5-dihydrothieno[2,3-c]pyridin-7-yl)quinoline), (15.069) (1-(4,5-dimethyl-1H-benzimidazol-1-yl)-4,4-difluoro-3,3-dimethyl-3,4-dihydroisoquinoline), (15.070) 8-fluoro-3-(5-fluoro-3,3-dimethyl-3,4-dihydroisoquinolin-1-yl)quinolone, (15.071) 8-fluoro-3-(5-fluoro-3,3,4,4-tetramethyl-3,4-dihydroisoquinolin-1-yl)quinolone, (15.072) 3-(4,4-difluoro-3,3-dimethyl-3,4-dihydroisoquinolin-1-yl)-8-fluoroquinoline, (15.073) (N-methyl-N-phenyl-4-[5-(trifluoromethyl)-1,2,4-oxadiazol-3-yl]benzamide), (15.074) methyl {4-[5-(trifluoromethyl)-1,2,4-oxadiazol-3-yl]phenyl}carbamate, (15.075) (N-{4-[5-(trifluoromethyl)-1,2,4-oxadiazol-3-yl]benzyl}cyclopropanecarboxamide), (15.076) N-methyl-4-(5-(trifluoromethyl)-1,2,4-oxadiazol-3-yl]benzamide, (15.077) N-[(E)-methoxyiminomethyl]-4-[5-(trifluoromethyl)-1,2,4-oxadiazol-3-yl]benzamide, (15.078) N—[(Z)-methoxyiminomethyl]-4-[5-(trifluoromethyl)-1,2,4-oxadiazol-3-yl]benzamide, (15.079) N-[4-[5-(trifluoromethyl)-1,2,4-oxadiazol-3-yl]phenyl]cyclopropanecarboxamide, (15.080) N-(2-fluorophenyl)-4-[5-(trifluoromethyl)-1,2,4-oxadiazol-3-yl]benzamide, (15.081) 2,2-difluoro-N-methyl-2-[4-[5-(trifluoromethyl)-1,2,4-oxadiazol-3-yl]phenyl]acetamide, (15.082) N-allyl-N-[[4-[5-(trifluoromethyl)-1,2,4-oxadiazol-3-yl)phenyl]methyl]acetamide, (15.083) N-[(E)-N-methoxy-C-methyl-carbonimidoyl]-4-(5-(trifluoromethyl)-1,2,4-oxadiazol-3-yl]benzamide, (15.084) N—[(Z)—N-methoxy-C-methyl-carbonimidoyl]-4-[5-(trifluoromethyl)-1,2,4-oxadiazol-3-yl]benzamide, (15.085) N-allyl-N-[[4-[5-(trifluoromethyl)-1,2,4-oxadiazol-3-yl]phenyl]methyl]propanamide, (15.086) 4,4-dimethyl-1-[[4-[5-(trifluoromethyl)-1,2,4-oxadiazol-3-yl]phenyl]methyl]-pyrrolidin-2-one, (15.087) N-methyl-4-[5-(trifluoromethyl)-1,2,4-oxadiazol-3-yl]-benzenecarbothioamide, (15.088) 5-methyl-[[4-[5-(trifluoromethyl)-1,2,4-oxadiazol-3-yl]phenyl]methyl]pyrrolidin-2-one, (15.089) N-((2,3-difluoro-4-[5-(trifluoromethyl)-1,2,4-oxadiazol-3-yl]phenyl]methyl]-3,3,3-trifluoro-propanamide, (15.090) 1-methoxy-1-methyl-3-[[4-[5-(trifluoromethyl}-1,2,4-oxadiazol-3-yl]phenyl]methyl]urea, (15.091) 1,1-diethyl-3-[[4-[5-(trifluoromethyl}-1,2,4-oxadiazol-3-yl]phenyl]methyl]urea, (15.092) N-[[4-[5-(trifluoromethyl)-1,2,4-oxadiazol-3-yl]phenyl]methyl]propanamide, (15.093) N-methoxy-N-[[4-[5-(trifluoromethyl)-1,2,4-oxadiazol-3-yl]phenyl]-methyl]cyclopropanecarboxamide, (15.094) 1-methoxy-3-methyl-1-[[4-[5-(trifluoromethyl)-1,2,4-oxadiazol-3-yl]phenyl]methyl]urea, (15.095) N-methoxy-N-[[4-[5-(trifluoromethyl)-1,2,4-oxadiazol-3-yl]phenyl]methyl)cyclopropanecarboxamide, (15.096) N,2-dimethoxy-N-[[4-[5-(trifluoromethyl}-1,2,4-oxadiazol-3-yl]phenyl]-methyl]propanamide, (15.097) N-ethyl-2-methyl-N-[[4-[5-(trifluoromethyl)-1,2,4-oxadiazol-3-yl)phenyl]methyl]propanamide, (15.098) 1-methoxy-3-methyl-1-[[4-[5-(trifluoromethyl)-1,2,4-oxadiazol-3-yl]phenyl]methyl]urea, (15.099) 1,3-dimethoxy-1-[[4-[5-(trifluoromethyl)-1,2,4-oxadiazol-3-yl]phenyl]methyl]urea, (15.100) 3-ethyl-1-methoxy-1-[[4-[5-(trifluoromethyl)-1,2,4-oxadiazol-3-yl]phenyl]methyl]urea, (15.101) 1-[[4-[5-(trifluoromethyl)-1,2,4-oxadiazol-3-yl]phenyl]methyl]piperidin-2-one, (15.102) 4,4-dimethyl-2-[[4-[5-(trifluoromethyl)-1,2,4-oxadiazol-3-yl]phenyl]-methyl]isooxazolidin-3-one, (15.103) 5,5-dimethyl-2-[[4-[5-(trifluoromethyl)-1,2,4-oxadiazol-3-yl]phenyl]methyl]isoxazolidin-3-one, (15.104) 3,3-dimethyl-1-[[4-[5-(trifluoromethyl)-1,2,4-oxadiazol-3-yl]phenyl]methyl]piperidin-2-one, (15.105) 1-[[3-fluoro-4-(5-(trifluoromethyl)-1,2,4-oxadiazol-3-yl]phenyl]methyl]azepan-2-one, (15.106) 4,4-dimethyl-2-[[4-(5-(trifluoromethyl)-1,2,4-oxadiazol-3-yl]phenyl]-methyl]isoxazolidin-3-one, (15.107) 5,5-dimethyl-2-[[4-[5-(trifluoromethyl)-1,2,4-oxadiazol-3-yl]phenyl]methyl]isoxazolidin-3-one, (15.108) ethyl 1-{4-[5-(trifluoromethyl)-1,2,4-oxadiazol-3-yl]benzyl}-1H-pyrazole-4-carboxylate, (15.109) N,N-dimethyl-1-{4-[5-(trifluoromethyl)-1,2,4-oxadiazol-3-yl]benzyl}-1H-1,2,4-triazol-3-amine, (15.110) N-{2,3-difluoro-4-[5-(trifluoromethyl)-1,2,4-oxadiazol-3-yl]benzyl}butanamide, (15.111) N-(1-methylcyclopropyl)-4-[5-(trifluoromethyl)-1,2,4-oxadiazol-3-yl]benzamide, (15.112) N-(2,4-difluorophenyl)-4-[5-(trifluoromethyl)-1,2,4-oxadiazol-3-yl]benzamide, (15.113) 1-(5,6-dimethylpyridin-3-yl)-4,4-difluoro-3,3-dimethyl-3,4-dihydroisoquinoline, (15.114) 1-(6-(difluoromethyl)-5-methyl-pyridin-3-yl)-4,4-difluoro-3,3-dimethyl-3,4-dihydroisoquinoline, (15.115) 1-(5-(fluoromethyl)-6-methyl-pyridin-3-yl)-4,4-difluoro-3,3-dimethyl-3,4-dihydroisoquinoline, (15.116) 1-(6-(difluoromethyl)-5-methoxy-pyridin-3-yl)-4,4-difluoro-3,3-dimethyl-3,4-dihydroisoquinoline, (15.117) 4-[5-(trifluoromethyl)-1,2,4-oxadiazol-3-yl]phenyl dimethylcarbamate, (15.118) N-4-[5-(trifluoromethyl)-1,2,4-oxadiazol-3-yl]phenyl propanamide, (15.119) 3-[2-(1-{[5-methyl-3-(trifluoromethyl)-1H-pyrazol-1-yl]acetyl}piperidin-4-yl)-1,3-thiazol-4-yl]-1,5-dihydro-2,4-benzodioxepin-6-yl methanesulfonate, (15.120) 9-fluoro-3-[2-(1-{[5-methyl-3-(trifluoromethyl)-1H-pyrazol-1-yl]acetyl}piperidin-4-yl)-1,3-thiazol-4-yl]-1,5-dihydro-2,4-benzodioxepin-6-yl methanesulfonate, (15.121) 3-[2-(1-{[3,5-bis(difluoromethyl)-1H-pyrazol-1-yl]acetyl}piperidin-4-yl)-1,3-thiazol-4-yl]-1,5-dihydro-2,4-benzodioxepin-6-yl methanesulfonate, (15.122) 3-[2-(1-{[3,5-bis(difluoromethyl)-1H-pyrazol-1-yl]acetyl}piperidin-4-yl)-1,3-thiazol-4-yl]-9-fluoro-1,5-dihydro-2,4-benzodioxepin-6-yl methanesulfonate, (15.123) 1-(6,7-dimethylpyrazolo[1,5-a]pyridin-3-yl)-4,4-difluoro-3,3-dimethyl-3,4-dihydroisoquinoline, (15.124) 8-fluoro-N-(4,4,4-trifluoro-2-methyl-1-phenylbutan-2-yl)quinoline-3-carboxamide, (15.125) 8-fluoro-N-[(2S)-4,4,4-trifluoro-2-methyl-1-phenylbutan-2-yl]quinoline-3-carboxamide, (15.126) N-(2,4-dimethyl-1-phenylpentan-2-yl)-8-fluoroquinoline-3-carboxamide and (15.127) N-[(2S)-2,4-dimethyl-1-phenylpentan-2-yl]-8-fluoroquinoline-3-carboxamide
(16) Antibacterial agents selected from the group of:
   bacteria, such as (16.001) Bacillus subtilis, in particular strain QST713/AQ713 (available as SERENADE OPTI or SERENADE ASO from Bayer CropScience LP, US, having NRRL Accession No. B21661 and described in U.S. Pat. No. 6,060,051); (16.002) Bacillus amyloliquefaciens, in particular strain D747 (available as Double Nickel™ from Certis, US, having accession number FERM BP-8234 and disclosed in U.S. Pat. No. 7,094,592); (16.003) Bacillus pumilus, in particular strain BU F-33 (having NRRL Accession No. 50185); (16.004) Bacillus subtilis var. amyloliquefaciens strain FZB24 (available as Taegro® from Novozymes, US); (16.005) a Paenibacillus sp. strain having Accession No. NRRL B-50972 or Accession No. NRRL B-67129 and described in International Patent Publication No. WO 2016/154297; and
   fungi, such as (16.006) Aureobasidium pullulans, in particular blastospores of strain DSM14940; 16.007) Aureobasidium pullulans blastospores of strain DSM 14941; (16.008) Aureobasidium pullulans, in particular mixtures of blastospores of strains DSM14940 and DSM14941;
(17) biological fungicides selected from the group of:
   bacteria, for example (17.001) Bacillus subtilis, in particular strain QST713/AQ713 (available as SERENADE OPTI or SERENADE ASO from Bayer CropScience LP, US, having NRRL Accession No. B21661 and described in U.S. Pat. No. 6,060,051); (17.002) Bacillus pumilus, in particular strain QST2808 (available as SONATA® from Bayer CropScience LP, US, having Accession No. NRRL B-30087 and described in U.S. Pat. No. 6,245,551); (17.003) Bacillus pumilus, in particular strain GB34 (available as Yield Shield® from Bayer AG, DE); (17.004) Bacillus pumilus, in particular strain BU F-33 (having NRRL Accession No. 50185); (17.005) Bacillus amyloliquefaciens, in particular strain D747 (available as Double Nickel™ from Certis, US, having accession number FERM BP-8234 and disclosed in U.S. Pat. No. 7,094,592); (17.006) Bacillus subtilis Y1336 (available as BIOBAC® WP from Bion-Tech, Taiwan, registered as a biological fungicide in Taiwan under Registration Nos. 4764, 5454, 5096 and 5277); (17.007) Bacillus amyloliquefaciens strain MBI 600 (available as SUBTILEX from BASF SE); (17.008) Bacillus subtilis strain GB03 (available as Kodiak® from Bayer AG, DE); (17.009) Bacillus subtilis var. amyloliquefaciens strain FZB24 (available from Novozymes Biologicals Inc., Salem, Va. or Syngenta Crop Protection, LLC, Greensboro, N.C. as the fungicide TAEGRO® or TAEGRO® ECO (EPA Registration No. 70127-5); (17.010) Bacillus mycoides, isolate J (available as BmJ TGAI or WG from Certis USA); (17.011) Bacillus licheniformis, in particular strain SB3086 (available as EcoGuard™ Biofungicide and Green Releaf from Novozymes); (17.012) a Paenibacillus sp. strain having Accession No. NRRL B-50972 or Accession No. NRRL B-67129 and described in International Patent Publication No. WO 2016/154297,
(18) fatty acids or derivatives,
   for example (18.001) a composition comprising one or more fatty acids or derivatives thereof selected from unsaturated and saturated C₁₂-C₂₄ fatty acids, salts thereof, esters thereof or mixtures of any of the foregoing, wherein at least 95% of said fatty acids or derivatives thereof are in the range of C₁₄ to C₂₀ (e.g. FLiPPER by AlphaBio Pesticides or Bayer AG).

Compound (B) is preferably selected from:

inhibitors of the ergosterol biosynthesis selected from the group consisting of (1.001) cyproconazole, (1.002) difenoconazole, (1.003) epoxiconazole, (1.004) fenhexamid, (1.005) fenpropidin, (1.006) fenpropimorph, (1.007) fenpyrazamine, (1.008) fluquinconazole, (1.009) flutriafol, (1.010) imazalil, (1.011) imazalil sulfate, (1.012) ipconazole, (1.013) metconazole, (1.014) myclobutanil, (1.015) paclobutrazol, (1.016) prochloraz, (1.017) propiconazole, (1.018) prothioconazole, (1.019) pyrisoxazole, (1.020) spiroxamine, (1.021) tebuconazole, (1.022) tetraconazole, (1.023) triadimenol, (1.024) tridemorph, (1.025) triticonazole, (1.026) (1R,2S,5S)-5-(4-chlorobenzyl)-2-(chloromethyl)-2-methyl-1-(1H-1,2,4-triazol-1-ylmethyl)cyclopentanol, (1.027) (1S,2R,5R)-5-(4-chlorobenzyl)-2-(chloromethyl)-2-methyl-1-(1H-1,2,4-triazol-1-ylmethyl)cyclopentanol, (1.028) (2R)-2-(1-chlorocyclopropyl)-4-[(1R)-2,2-dichlorocyclopropyl]-1-(1H-1,2,4-triazol-1-yl)butan-2-ol, (1.029) (2R)-2-(1-chlorocyclopropyl)-4-[(1S)-2,2-dichlorocyclopropyl]-1-(1H-1,2,4-triazol-1-yl)butan-2-ol, (1.030) (2R)-2-[4-(4-chlorophenoxy)-2-(trifluoromethyl)phenyl]-1-(1H-1,2,4-triazol-1-yl)propan-2-ol, (1.031) (2S)-2-(1-chlorocyclopropyl)-4-[(1R)-2,2-dichlorocyclopropyl]-1-(1H-1,2,4-triazol-1-yl)butan-2-ol, (1.032) (2S)-2-(1-chlorocyclopropyl)-4-[(1S)-2,2-dichlorocyclopropyl]-1-(1H-1,2,4-triazol-1-yl)butan-2-ol, (1.033) (2S)-2-[4-(4-chlorophenoxy)-2-(trifluoromethyl)phenyl]-1-(1H-1,2,4-triazol-1-yl)propan-2-ol, (1.034) (R)-[3-(4-chloro-2-fluorophenyl)-5-(2,4-difluorophenyl)-1,2-oxazol-4-yl](pyridin-3-yl)methanol, (1.035) (S)-[3-(4-chloro-2-fluorophenyl)-5-(2,4-difluorophenyl)-1,2-oxazol-4-yl](pyridin-3-yl)methanol, (1.036) [3-(4-chloro-2-fluorophenyl)-5-(2,4-difluorophenyl)-1,2-oxazol-4-yl](pyridin-3-yl)methanol, (1.037) 1-({(2R,4S)-2-[2-chloro-4-(4-chlorophenoxy)phenyl]-4-methyl-1,3-dioxolan-2-yl}methyl)-1H-1,2,4-triazole, (1.038) 1-({(2S,4S)-2-[2-chloro-4-(4-chlorophenoxy)phenyl]-4-methyl-1,3-dioxolan-2-yl}methyl)-1H-1,2,4-triazole, (1.039) 1-{[3-(2-chlorophenyl)-2-(2,4-difluoro-phenyl)oxiran-2-yl]methyl}-1H-1,2,4-triazol-5-yl thiocyanate, (1.040) 1-{[rel(2R,3R)-3-(2-chlorophenyl)-2-(2,4-difluorophenyl)oxiran-2-yl]methyl}-1H-1,2,4-triazol-5-yl thiocyanate, (1.041) 1-{[rel(2R,3S)-3-(2-chlorophenyl)-2-(2,4-difluorophenyl)oxiran-2-yl]methyl}-1H-1,2,4-triazol-5-yl thiocyanate, (1.042) 2-[(2R,4R,5R)-1-(2,4-dichlorophenyl)-5-hydroxy-2,6,6-trimethylheptan-4-yl]-2,4-dihydro-3H-1,2,4-triazole-3-thione, (1.043) 2-[(2R,4R,5S)-1-(2,4-dichlorophenyl)-5-hydroxy-2,6,6-trimethylheptan-4-yl]-2,4-dihydro-3H-1,2,4-triazole-3-thione, (1.044) 2-[(2R,4S,5R)-1-(2,4-dichlorophenyl)-5-hydroxy-2,6,6-trimethylheptan-4-yl]-2,4-dihydro-3H-1,2,4-triazole-3-thione, (1.045) 2-[(2R,4S,5S)-1-(2,4-dichloro-phenyl)-5-hydroxy-2,6,6-trimethylheptan-4-yl]-2,4-dihydro-3H-1,2,4-triazole-3-thione, (1.046) 2-[(2S,4R,5R)-1-(2,4-dichlorophenyl)-5-hydroxy-2,6,6-trimethylheptan-4-yl]-2,4-dihydro-3H-1,2,4-triazole-3-thione, (1.047) 2-[(2S,4R,5S)-1-(2,4-dichlorophenyl)-5-hydroxy-2,6,6-trimethylheptan-4-yl]-2,4-dihydro-3H-1,2,4-triazole-3-thione, (1.048) 2-[(2S,4S,5R)-1-(2,4-dichlorophenyl)-5-hydroxy-2,6,6-trimethylheptan-4-yl]-2,4-dihydro-3H-1,2,4-triazole-3-thione, (1.049) 2-[(2S,4S,5S)-1-(2,4-dichloro-phenyl)-5-hydroxy-2,6,6-trimethylheptan-4-yl]-2,4-dihydro-3H-1,2,4-triazole-3-thione, (1.050) 2-[1-(2,4-dichlorophenyl)-5-hydroxy-2,6,6-trimethylheptan-4-yl]-2,4-dihydro-3H-1,2,4-triazole-3-thione, (1.051) 2-[2-chloro-4-(2,4-dichlorophenoxy)phenyl]-1-(1H-1,2,4-triazol-1-yl)propan-2-ol, (1.052) 2-[2-chloro-4-(4-chlorophenoxy)phenyl]-1-(1H-1,2,4-triazol-1-yl)butan-2-ol, (1.053) 2-[4-(4-chlorophenoxy)-2-(trifluoro-methyl)phenyl]-1-(1H-1,2,4-triazol-1-yl)butan-2-ol, (1.054) 2-[4-(4-chlorophenoxy)-2-(trifluoro-methyl)phenyl]-1-(1H-1,2,4-triazol-1-yl)pentan-2-ol, (1.055) mefentrifluconazole, (1.056) 2-{[3-(2-chloro-phenyl)-2-(2,4-difluorophenyl)oxiran-2-yl]methyl}-2,4-dihydro-3H-1,2,4-triazole-3-thione, (1.057) 2-{methyl}-2,4-dihydro-3H-1,2,4-triazole-3-thione, (1.058) 2-{[rel(2R,3S)-3-(2-chlorophenyl)-2-(2,4-difluorophenyl)oxiran-2-yl]methyl}-2,4-dihydro-3H-1,2,4-triazole-3-thione, (1.059) 5-(4-chlorobenzyl)-2-(chloromethyl)-2-methyl-1-(1H-1,2,4-triazol-1-ylmethyl)cyclopentanol, (1.060) 5-(allylsulfanyl)-1-{[3-(2-chlorophenyl)-2-(2,4-difluoro-phenyl)oxiran-2-yl]methyl}-1H-1,2,4-triazole, (1.061) 5-(allylsulfanyl)-1-{[rel(2R,3R)-3-(2-chlorophenyl)-2-(2,4-difluorophenyl)oxiran-2-yl]methyl}-1H-1,2,4-triazole, (1.062) 5-(allylsulfanyl)-1-{[rel(2R,3S)-3-(2-chlorophenyl)-2-(2,4-difluorophenyl)oxiran-2-yl]methyl}-1H-1,2,4-triazole, (1.063) N′-(2,5-dimethyl-4-{[3-(1,1,2,2-tetrafluoroethoxy)phenyl]sulfanyl}phenyl)-N-ethyl-N-methylimidoformamide, (1.064) N′-(2,5-dimethyl-4-{[3-(2,2,2-trifluoroethoxy)phenyl]sulfanyl}phenyl)N-ethyl-N-methylimidoformamide, (1.065) N′-(2,5-dimethyl-4-{[3-(2,2,3,3-tetrafluoropropoxy)phenyl]sulfanyl}phenyl)-N-ethyl-N-methylimidoformamide, (1.066) N′-(2,5-dimethyl-4-[3-(pentafluoroethoxy)phenyl]sulfanyl phenyl)-N-ethyl-N-methylimidoformamide, (1.067) N′-(2,5-dimethyl-4-{3-[(1,1,2,2-tetrafluoroethyl)sulfanyl]-phenoxy}phenyl)-N-ethyl-N-methylimidoformamide, (1.068) N′-(2,5-dimethyl-4-{3-[(2,2,2-trifluoro-ethyl)sulfanyl]phenoxy}phenyl)-N-ethyl-N-methylimidoformamide, (1.069) N′-(2,5-dimethyl-4-{3-[(2,2,3,3-tetrafluoropropyl)sulfanyl]phenoxy}phenyl)-N-ethyl-N-methylimidoformamide, (1.070) N′-(2,5-dimethyl-4-{3-[(pentafluoroethyl)sulfanyl]phenoxy}phenyl)-N-ethyl-N-methylimidoformamide, (1.071) N′-(2,5-dimethyl-4-phenoxyphenyl)-N-ethyl-N-methylimidoformamide, (1.072) N′-(4-{[3-(difluoro-methoxy)phenyl]sulfanyl}-2,5-dimethylphenyl)-N-ethyl-N-methylimidoformamide, (1.073) N′-(4-{3-[(difluoromethyl)sulfanyl]phenoxy}-2,5-dimethylphenyl)-N-ethyl-N-methylimidoformamide, (1.074) N′-[5-bromo-6-(2,3-dihydro-1H-inden-2-yloxy)-2-methylpyridin-3-yl]-N-ethyl-N-methylimidoformamide, (1.075) N′-{4-[(4,5-dichloro-1,3-thiazol-2-yl)oxy]-2,5-dimethylphenyl}-N-ethyl-N-methylimidoformamide, (1.076) N′-{5-bromo-6-[(1R)-1-(3,5-difluorophenyl)ethoxy]-2-methylpyridin-3-yl}-N-ethyl-N-methylimidoformamide, (1.077) N′-{5-bromo-6-[(1S)-1-(3,5-difluorophenyl)ethoxy]-2-methylpyridin-3-yl}-N-ethyl-N-methylimidoformamide, (1.078) N′-{5-bromo-6-[(cis-4-isopropylcyclohexyl)oxy]-2-methylpyridin-3-yl}-N-ethyl-N-methylimidoformamide, (1.079) N′-{5-bromo-6-[(trans-4-isopropylcyclohexyl)oxy]-2-methylpyridin-3-yl}-N-ethyl-N-methylimidoformamide, (1.080) N′-{5-bromo-6-[1-(3,5-difluorophenyl)ethoxy]-2-methylpyridin-3-yl}-N-ethyl-N-methylimidoformamide, (1.081) ipfentrifluconazole, (1.082) 2-[4-(4-chlorophenoxy)-2-(trifluoromethyl)phenyl]-1-(1H-1,2,4-triazol-1-yl)propan-2-ol, (1.083) 2-[6-(4-bromophenoxy)-2-(trifluoromethyl)-3-pyridyl]-1-(1,2,4-triazol-1-yl)propan-2-ol, (1.084) 2-[6-(4-chlorophenoxy)-2-(trifluoromethyl)-3-pyridyl]-1-(1,2,4-triazol-1-yl)propan-2-ol, (1.085) 3-[2-(1-chlorocyclopropyl)-3-(3-chloro-2-fluoro-phenyl)-2-hydroxy-propyl]imidazole-4-carbonitrile, (1.086) 4-[[6-[rac-(2R)-2-(2,4-difluorophenyl)-1,1-difluoro-2-hydroxy-3-(5-thioxo-4H-1,2,4-triazol-1-yl)propyl]-3-pyridyl]oxy]benzonitrile, (1.087) N-isopropyl-N′-[5-methoxy-2-methyl-4-(2,2,2-trifluoro-1-hydroxy-1-phenylethyl)phenyl]-N-methylimidoformamide, (1.088) N′-{5-bromo-2-methyl-6-[(1-propoxypropan-2-yl)oxy]pyridin-3-yl}-N-ethyl-N-methylimidoformamide, (1.089) hexaconazole, (1.090) penconazole, (1.091) fenbuconazole, (1.092) methyl 2-[2-chloro-4-(4-chlorophenoxy)phenyl]-2-hydroxy-3-(1,2,4-triazol-1-yl)propanoate

inhibitors of the respiratory chain at complex I or II selected from the group consisting of (2.001) benzovindiflupyr, (2.002) bixafen, (2.003) boscalid, (2.004) carboxin, (2.005) fluopyram, (2.006) flutolanil, (2.007) fluxapyroxad, (2.008) furametpyr, (2.009) Isofetamid, (2.010) isopyrazam (anti-epimeric enantiomer 1R,4S,9S), (2.011) isopyrazam (anti-epimeric enantiomer 1S,4R,9R), (2.012) isopyrazam (anti-epimeric racemate 1RS,4SR,9SR), (2.013) isopyrazam (mixture of syn-epimeric racemate 1RS,4SR,9RS and anti-epimeric racemate 1RS,4SR,9SR), (2.014) isopyrazam (syn-epimeric enantiomer 1R,4S,9R), (2.015) isopyrazam (syn-epimeric enantiomer 1S,4R,9S), (2.016) isopyrazam (syn-epimeric racemate 1RS,4SR,9RS), (2.017) penflufen, (2.018) penthiopyrad, (2.019) pydiflumetofen, (2.020) Pyraziflumid, (2.021) sedaxane, (2.022) 1,3-dimethyl-N-(1,1,3-trimethyl-2,3-dihydro-1H-inden-4-yl)-1H-pyrazole-4-carboxamide, (2.023) 1,3-dimethyl-N-[(3R)-1,1,3-trimethyl-2,3-dihydro-1H-inden-4-yl]-1H-pyrazole-4-carboxamide, (2.024) 1,3-dimethyl-N-[(3S)-1,1,3-trimethyl-2,3-dihydro-1H-inden-4-yl]-1H-pyrazole-4-carboxamide, (2.025) 1-methyl-3-(trifluoromethyl)-N-[2′-(trifluoromethyl)biphenyl-2-yl]-1H-pyrazole-4-carboxamide, (2.026) 2-fluoro-6-(trifluoromethyl)-N-(1,1,3-trimethyl-2,3-dihydro-1H-inden-4-yl)benzamide, (2.027) 3-(difluoromethyl)-1-methyl-N-(1,1,3-trimethyl-2,3-dihydro-1H-inden-4-yl)-1H-pyrazole-4-carboxamide, (2.028) inpyrfluxam, (2.029) 3-(difluoromethyl)-1-methyl-N-[(3S)-1,1,3-trimethyl-2,3-dihydro-1H-inden-4-yl]-1H-pyrazole-4-carboxamide, (2.030) fluindapyr, (2.031) 3-(difluoromethyl)-N-[(3R)-7-fluoro-1,1,3-trimethyl-2,3-dihydro-1H-inden-4-yl]-1-methyl-1H-pyrazole-4-carboxamide, (2.032) 3-(difluoromethyl)-N-[(3S)-7-fluoro-1,1,3-trimethyl-2,3-dihydro-1H-inden-4-yl]-1-methyl-1H-pyrazole-4-carboxamide, (2.033) 5,8-difluoro-N-[2-(2-fluoro-4-{[4-(trifluoromethyl)pyridin-2-yl]oxy}phenyl)ethyl]quinazolin-4-amine, (2.034) N-(2-cyclopentyl-5-fluorobenzyl)-N-cyclopropyl-3-(difluoromethyl)-5-fluoro-1-methyl-1H-pyrazole-4-carboxamide, (2.035) N-(2-tert-butyl-5-methylbenzyl)-N-cyclopropyl-3-(difluoromethyl)-5-fluoro-1-methyl-1H-pyrazole-4-carboxamide, (2.036) N-(2-tert-butylbenzyl)-N-cyclopropyl-3-(difluoromethyl)-5-fluoro-1-methyl-1H-pyrazole-4-carboxamide, (2.037) N-(5-chloro-2-ethylbenzyl)-N-cyclopropyl-3-(difluoromethyl)-5-fluoro-1-methyl-1H-pyrazole-4-carboxamide, (2.038) isoflucypram, (2.039) N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide, (2.040) N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide, (2.041) N-[1-(2,4-dichlorophenyl)-1-methoxypropan-2-yl]-3-(difluoromethyl)-1-methyl-1H-pyrazole-4-carboxamide, (2.042) N-[2-chloro-6-(trifluoromethyl)benzyl]-N-cyclopropyl-3-(difluoromethyl)-5-fluoro-1-methyl-1H-pyrazole-4-carboxamide, (2.043) N-[3-chloro-2-fluoro-6-(trifluoromethyl)benzyl]-N-cyclopropyl-3-(difluoromethyl)-5-fluoro-1-methyl-1H-pyrazole-4-carboxamide, (2.044) N-[5-chloro-2-(trifluoromethyl)benzyl]-N-cyclopropyl-3-(difluoromethyl)-5-fluoro-1-methyl-1H-pyrazole-4-carboxamide, (2.045) N-cyclopropyl-3-(difluoromethyl)-5-fluoro-1-methyl-N-[5-methyl-2-(trifluoromethyl)benzyl]-1H-pyrazole-4-carboxamide, (2.046) N-cyclopropyl-3-(difluoromethyl)-5-fluoro-N-(2-fluoro-6-isopropylbenzyl)-1-methyl-1H-pyrazole-4-carboxamide, (2.047) N-cyclopropyl-3-(difluoromethyl)-5-fluoro-N-(2-isopropyl-5-methylbenzyl)-1-methyl-1H-pyrazole-4-carboxamide, (2.048) N-cyclopropyl-3-(difluoromethyl)-5-fluoro-N-(2-isopropylbenzyl)-1-methyl-1H-pyrazole-4-carbothioamide, (2.049) N-cyclopropyl-3-(difluoromethyl)-5-fluoro-N-(2-isopropylbenzyl)-1-methyl-1H-pyrazole-4-carboxamide, (2.050) N-cyclopropyl-3-(difluoromethyl)-5-fluoro-N-(5-fluoro-2-isopropylbenzyl)-1-methyl-1H-pyrazole-4-carboxamide, (2.051) N-cyclopropyl-3-(difluoromethyl)-N-(2-ethyl-4,5-dimethylbenzyl)-5-fluoro-1-methyl-1H-pyrazole-4-carboxamide, (2.052) N-cyclopropyl-3-(difluoromethyl)-N-(2-ethyl-5-fluorobenzyl)-5-fluoro-1-methyl-1H-pyrazole-4-carboxamide, (2.053) N-cyclopropyl-3-(difluoromethyl)-N-(2-ethyl-5-methylbenzyl)-5-fluoro-1-methyl-1H-pyrazole-4-carboxamide, (2.054) N-cyclopropyl-N-(2-cyclopropyl-5-fluorobenzyl)-3-(difluoromethyl)-5-fluoro-1-methyl-1H-pyrazole-4-carboxamide, (2.055) N-cyclopropyl-N-(2-cyclopropyl-5-methylbenzyl)-3-(difluoromethyl)-5-fluoro-1-methyl-1H-pyrazole-4-carboxamide, (2.056) N-cyclopropyl-N-(2-cyclopropylbenzyl)-3-(difluoromethyl)-5-fluoro-1-methyl-1H-pyrazole-4-carboxamide, (2.057) pyrapropoyne, (2.058) N-[rac-(1S,2S)-2-(2,4-dichlorophenyl)cyclobutyl]-2-(trifluoromethyl)nicotinamide, (2.059) N-[(1S,2S)-2-(2,4-dichlorophenyl)cyclobutyl]-2-(trifluoromethyl)nicotinamide, (2.060) flubeneteram.

inhibitors of the respiratory chain at complex III selected from the group consisting of (3.001) ametoctradin, (3.002) amisulbrom, (3.003) azoxystrobin, (3.004) coumethoxystrobin, (3.005) coumoxystrobin, (3.006) cyazofamid, (3.007) dimoxystrobin, (3.008) enoxastrobin, (3.009) famoxadone, (3.010) fenamidone, (3.011) flufenoxystrobin, (3.012) fluoxastrobin, (3.013) kresoxim-methyl, (3.014) metominostrobin, (3.015) orysastrobin, (3.016) picoxystrobin, (3.017) pyraclostrobin, (3.018) pyrametostrobin, (3.019) pyraoxystrobin, (3.020) trifloxystrobin, (3.021) (2E)-2-{2-[({[(1E)-1-(3-{[(E)-1-fluoro-2-phenyl-vinyl]oxy}phenyl)ethylidene]amino}oxy)methyl]phenyl}-2-(methoxyimino)-N-methylacetamide, (3.022) (2E,3Z)-5-{[1-(4-chlorophenyl)-1H-pyrazol-3-yl]oxy}-2-(methoxyimino)-N,3-dimethylpent-3-enamide, (3.023) (2R)-2-{2-[(2,5-dimethylphenoxy)methyl]phenyl}-2-methoxy-N-methylacetamide, (3.024) (2S)-2-{2-[(2,5-dimethylphenoxy)methyl]phenyl}-2-methoxy-N-methylacetamide, (3.025) fenpicoxamid, (3.026) mandestrobin, (3.027) N-(3-ethyl-3,5,5-trimethylcyclohexyl)-3-formamido-2-hydroxybenzamide, (3.028) (2E,3Z)-5-{[1-(4-chloro-2-fluorophenyl)-1H-pyrazol-3-yl]oxy}-2-(methoxyimino)-N,3-dimethylpent-3-enamide, (3.029) methyl {5-[3-(2,4-dimethylphenyl)-1H-pyrazol-1-yl]-2-methylbenzyl}carbamate, (3.030) metyltetraprole, (3.031) florylpicoxamid, (3.032) (2S,3S)-3-(o-tolyl)butan-2-yl N-{[4-methoxy-3-(propanoyloxy)-2-pyridyl]carbonyl}-L-alaninate

inhibitors of the mitosis and cell division selected from the group consisting of (4.001) carbendazim, (4.002) diethofencarb, (4.003) ethaboxam, (4.004) fluopicolide, (4.005) pencycuron, (4.006) thiabendazole, (4.007) thiophanate-methyl, (4.008) zoxamide, (4.009) pyridachlometyl, (4.010) 3-chloro-5-(4-chlorophenyl)-4-(2,6-difluorophenyl)-6-methylpyridazine, (4.011) 3-chloro-5-(6-chloropyridin-3-yl)-6-methyl-4-(2,4,6-trifluorophenyl)pyridazine, (4.012) 4-(2-bromo-4-fluorophenyl)-N-(2,6-difluorophenyl)-1,3-dimethyl-1H-pyrazol-5-amine, (4.013) 4-(2-bromo-4-fluorophenyl)-N-(2-bromo-6-fluorophenyl)-1,3-dimethyl-1H-pyrazol-5-amine, (4.014) 4-(2-bromo-4-fluorophenyl)-N-(2-bromophenyl)-1,3-dimethyl-1H-pyrazol-5-amine, (4.015) 4-(2-bromo-4-fluorophenyl)-N-(2-chloro-6-fluorophenyl)-1,3-dimethyl-1H-pyrazol-5-amine, (4.016) 4-(2-bromo-4-fluorophenyl)-N-(2-chlorophenyl)-1,3-dimethyl-1H-pyrazol-5-amine, (4.017) 4-(2-bromo-4-fluorophenyl)-N-(2-fluorophenyl)-1,3-dimethyl-1H-pyrazol-5-amine, (4.018) 4-(2-chloro-4-fluorophenyl)-N-(2,6-difluorophenyl)-1,3-dimethyl-1H-pyrazol-5-amine, (4.019) 4-(2-chloro-4-fluorophenyl)-N-(2-chloro-6-fluorophenyl)-1,3-dimethyl-1H-pyrazol-5-amine, (4.020) 4-(2-chloro-4-fluorophenyl)-N-(2-chlorophenyl)-1,3-dimethyl-1H-pyrazol-5-amine, (4.021) 4-(2-chloro-4-fluorophenyl)-N-(2-fluorophenyl)-1,3-dimethyl-1H-pyrazol-5-amine, (4.022) 4-(4-chlorophenyl)-5-(2,6-difluorophenyl)-3,6-dimethylpyridazine, (4.023) N-(2-bromo-6-fluorophenyl)-4-(2-chloro-4-fluorophenyl)-1,3-dimethyl-1H-pyrazol-5-amine, (4.024) N-(2-bromophenyl)-4-(2-chloro-4-fluorophenyl)-1,3-dimethyl-1H-pyrazol-5-amine, (4.025) N-(4-chloro-2,6-difluorophenyl)-4-(2-chloro-4-fluorophenyl)-1,3-dimethyl-1H-pyrazol-5-amine, (4.026) fluopimomide,

compounds capable to have a multisite action selected from the group consisting of (5.001) bordeaux mixture, (5.002) captafol, (5.003) captan, (5.004) chlorothalonil, (5.005) copper hydroxide, (5.006) copper naphthenate, (5.007) copper oxide, (5.008) copper oxychloride, (5.009) copper(2+) sulfate, (5.010) dithianon, (5.011) dodine, (5.012) folpet, (5.013) mancozeb, (5.014) maneb, (5.015) metiram, (5.016) metiram zinc, (5.017) oxine-copper, (5.018) propineb, (5.019) sulfur and sulfur preparations including calcium polysulfide, (5.020) thiram, (5.021) zineb, (5.022) ziram, (5.023) 6-ethyl-5,7-dioxo-6,7-dihydro-5H-pyrrolo[3′,4′:5,6][1,4]dithiino[2,3-c][1,2]thiazole-3-carbonitrile,

compounds capable to induce a host defence selected from the group consisting of (6.001) acibenzolar-S-methyl, (6.002) isotianil, (6.003) probenazole, (6.004) tiadinil,

inhibitors of the amino acid and/or protein biosynthesis selected from the group consisting of (7.001) cyprodinil, (7.002) kasugamycin, (7.003) kasugamycin hydrochloride hydrate, (7.004) oxytetracycline, (7.005) pyrimethanil, (7.006) 3-(5-fluoro-3,3,4,4-tetramethyl-3,4-dihydroisoquinolin-1-yl)quinoline,

inhibitors of the ATP production selected from the group consisting of (8.001) silthiofam,

inhibitors of the cell wall synthesis selected from the group consisting of (9.001) benthiavalicarb, (9.002) dimethomorph, (9.003) flumorph, (9.004) iprovalicarb, (9.005) mandipropamid, (9.006) pyrimorph, (9.007) valifenalate, (9.008) (2E)-3-(4-tert-butylphenyl)-3-(2-chloropyridin-4-yl)-1-(morpholin-4-yl)prop-2-en-1-one, (9.009) (2Z)-3-(4-tert-butylphenyl)-3-(2-chloropyridin-4-yl)-1-(morpholin-4-yl)prop-2-en-1-one,

inhibitors of the lipid and membrane synthesis selected from the group consisting of (10.001) propamocarb, (10.002) propamocarb hydrochloride, (10.003) tolclofos-methyl,

inhibitors of the melanin biosynthesis selected from the group consisting of (11.001) tricyclazole, (11.002) tolprocarb,

inhibitors of the nucleic acid synthesis selected from the group consisting of (12.001) benalaxyl, (12.002) benalaxyl-M (kiralaxyl), (12.003) metalaxyl, (12.004) metalaxyl-M (mefenoxam),

inhibitors of the signal transduction selected from the group consisting of (13.001) fludioxonil, (13.002) iprodione, (13.003) procymidone, (13.004) proquinazid, (13.005) quinoxyfen, (13.006) vinclozolin,

compounds capable to act as an uncoupler selected from the group consisting of (14.001) fluazinam, (14.002) meptyldinocap,

further fungicides selected from the group consisting of (15.001) abscisic acid, (15.002) benthiazole, (15.003) bethoxazin, (15.004) capsimycin, (15.005) carvone, (15.006) chinomethionat, (15.007) cufraneb, (15.008) cyflufenamid, (15.009) cymoxanil, (15.010) cyprosulfamide, (15.011) flutianil, (15.012) fosetyl-aluminium, (15.013) fosetyl-calcium, (15.014) fosetyl-sodium, (15.015) methyl isothiocyanate, (15.016) metrafenone, (15.017) mildiomycin, (15.018) natamycin, (15.019) nickel dimethyldithiocarbamate, (15.020) nitrothal-isopropyl, (15.021) oxamocarb, (15.022) oxathiapiprolin, (15.023) oxyfenthiin, (15.024) pentachlorophenol and salts, (15.025) phosphorous acid and its salts, (15.026) propamocarb-fosetylate, (15.027) pyriofenone (chlazafenone), (15.028) tebufloquin, (15.029) tecloftalam, (15.030) tolnifanide, (15.031) 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.032) 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoro-methyl)-1H-pyrazol-1-yl]ethanone, (15.033) 2-(6-benzylpyridin-2-yl)quinazoline, (15.034) dipymetitrone, (15.035) 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl)piperidin-1-yl]ethanone, (15.036) 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-ethanone, (15.037) 2-[3,5-bis(difluoromethyl)-1H-pyrazol-1-yl]-1-[4-(4-{5-[2-fluoro-6-(prop-2-yn-1-yloxy)phenyl]-4,5-dihydro-1,2-oxazol-3-yl}-1,3-thiazol-2-yl)piperidin-1-yl]ethanone, (15.038) 2-[6-(3-fluoro-4-methoxyphenyl)-5-methylpyridin-2-yl]quinazoline, (15.039) 2-{(5R)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.040) 2-{(5S)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.041) ipflufenoquin, (15.042) 2-{2-fluoro-6-[(8-fluoro-2-methylquinolin-3-yl)oxy]phenyl}propan-2-ol, (15.043) fluoxapiprolin, (15.044) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}phenyl methanesulfonate, (15.045) 2-phenylphenol and salts, (15.046) 3-(4,4,5-trifluoro-3,3-dimethyl-3,4-dihydroisoquinolin-1-yl)quinoline, (15.047) quinofumelin, (15.048) 4-amino-5-fluoropyrimidin-2-ol (tautomeric form: 4-amino-5-fluoropyrimidin-2(1H)-one), (15.049) 4-oxo-4-[(2-phenyl-ethyl)amino]butanoic acid, (15.050) 5-amino-1,3,4-thiadiazole-2-thiol, (15.051) 5-chloro-N′-phenyl-N′-(prop-2-yn-1-yl)thiophene-2-sulfonohydrazide, (15.052) 5-fluoro-2-[(4-fluorobenzyl)oxy]pyrimidin-4-amine, (15.053) 5-fluoro-2[(4-methylbenzyl)oxy]pyrimidin-4-amine, (15.054) 9-fluoro-2,2-dimethyl-5-(quinolin-3-yl)-2,3-dihydro-1,4-benzoxazepine, (15.055) but-3-yn-1-yl {6-[({[(Z)-(1-methyl-1H-tetrazol-5-yl)(phenyl)methylene]amino}oxy)methyl]pyridin-2-yl}carbamate, (15.056) ethyl (2Z)-3-amino-2-cyano-3-phenylacrylate, (15.057) phenazine-1-carboxylic acid, (15.058) propyl 3,4,5-trihydroxybenzoate, (15.059) quinolin-8-ol, (15.060) quinolin-8-ol sulfate (2:1), (15.061) tert-butyl {6-[({[(1-methyl-1H-tetrazol-5-yl)(phenyl)methylene]amino}oxy)methyl]pyridin-2-yl}carbamate, (15.062) 5-fluoro-4-imino-3-methyl-1-[(4-methylphenyl)sulfonyl]-3,4-dihydropyrimidin-2(1H)-one, (15.063) aminopyrifen, (15.064) (N′-[2-chloro-4-(2-fluorophenoxy)-5-methylphenyl]-N-ethyl-N-methylimidoformamide), (15.065) (N′-(2-chloro-5-methyl-4-phenoxyphenyl)-N-ethyl-N-methylimidoformamide), (15.066) (2-{2-[(7,8-difluoro-2-methylquinolin-3-yl)oxy]-6-fluorophenyl}propan-2-ol), (15.067) (5-bromo-1-(5,6-dimethylpyridin-3-yl)-3,3-dimethyl-3,4-dihydroisoquinoline), (15.068) (3-(4,4-difluoro-5,5-dimethyl-4,5-dihydrothieno[2,3-c]pyridin-7-yl)quinoline), (15.069) (1-(4,5-dimethyl-1H-benzimidazol-1-yl)-4,4-difluoro-3,3-dimethyl-3,4-dihydroisoquinoline), (15.070) 8-fluoro-3-(5-fluoro-3,3-dimethyl-3,4-dihydroisoquinolin-1-yl)quinolone, (15.071) 8-fluoro-3-(5-fluoro-3,3,4,4-tetramethyl-3,4-dihydroisoquinolin-1-yl)quinolone, (15.072) 3-(4,4-difluoro-3,3-dimethyl-3,4-dihydroisoquinolin-1-yl)-8-fluoroquinoline, (15.073) (N-methyl-N-phenyl-4-[5-(trifluoromethyl)-1,2,4-oxadiazol-3-yl]benzamide), (15.074) methyl {4-[5-(trifluoromethyl)-1,2,4-oxadiazol-3-yl]phenyl}carbamate, (15.075) (N-{4-[5-(trifluoromethyl)-1,2,4-oxadiazol-3-yl]benzyl}-cyclopropanecarboxamide), (15.076) N-methyl-4-(5-(trifluoromethyl)-1,2,4-oxadiazol-3-yl]benzamide, (15.077) N-[(E)-methoxyiminomethyl]-4-[5-(trifluoromethyl)-1,2,4-oxadiazol-3-yl]benzamide, (15.078) N—[(Z)-methoxyiminomethyl]-4-[5-(trifluoromethyl)-1,2,4-oxadiazol-3-yl]benzamide, (15.079) N-[4-[5-(trifluoromethyl)-1,2,4-oxadiazol-3-yl]phenyl]cyclopropanecarboxamide, (15.080) N-(2-fluorophenyl)-4-[5-(trifluoromethyl)-1,2,4-oxadiazol-3-yl]benzamide, (15.081) 2,2-difluoro-N-methyl-2-[4-[5-(trifluoromethyl)-1,2,4-oxadiazol-3-yl]phenyl]acetamide, (15.082) N-allyl-N-[[4-[5-(trifluoromethyl)-1,2,4-oxadiazol-3-yl)phenyl]methyl]acetamide, (15.083) N-[(E)-N-methoxy-C-methyl-carbonimidoyl]-4-(5-(trifluoromethyl)-1,2,4-oxadiazol-3-yl]benzamide, (15.084) N—[(Z)-N-methoxy-C-methyl-carbonimidoyl]-4-[5-(trifluoromethyl)-1,2,4-oxadiazol-3-yl]benzamide, (15.085) N-allyl-N-[[4-[5-(trifluoromethyl)-1,2,4-oxadiazol-3-yl]phenyl]methyl]propanamide, (15.086) 4,4-dimethyl-1-[[4-[5-(trifluoromethyl)-1,2,4-oxadiazol-3-yl]phenyl]methyl]pyrrolidin-2-one, (15.087) N-methyl-4-[5-(trifluoromethyl)-1,2,4-oxadiazol-3-yl]benzenecarbothioamide, (15.088) 5-methyl-1-[[4-[5-(trifluoro-methyl)-1,2,4-oxadiazol-3-yl]phenyl]methyl]pyrrolidin-2-one, (15.089) N-((2,3-difluoro-4-[5-(trifluoro-methyl)-1,2,4-oxadiazol-3-yl]phenyl]methyl]-3,3,3-trifluoro-propanamide, (15.090) 1-methoxy-1-methyl-3-[[4-[5-(trifluoromethyl}-1,2,4-oxadiazol-3-yl]phenyl]methyl]urea, (15.091) 1,1-diethyl-3-[[4-[5-(trifluoromethyl}-1,2,4-oxadiazol-3-yl]phenyl]methyl]urea, (15.092) N-[[4-[5-(trifluoromethyl)-1,2,4-oxadiazol-3-yl]phenyl]methyl]propanamide, (15.093) N-methoxy-N-[[4-[5-(trifluoromethyl)-1,2,4-oxadiazol-3-yl]phenyl]methyl]cyclopropanecarboxamide, (15.094) 1-methoxy-3-methyl-1-[[4-[5-(trifluoromethyl)-1,2,4-oxadiazol-3-yl]phenyl]methyl]urea, (15.095) N-methoxy-N-[[4-[5-(trifluoro-methyl)-1,2,4-oxadiazol-3-yl]phenyl]methyl)cyclopropanecarboxamide, (15.096) N,2-dimethoxy-N-[[4-[5-(trifluoromethyl}-1,2,4-oxadiazol-3-yl]phenyl]methyl]propanamide, (15.097) N-ethyl-2-methyl-N-[[4-[5-(trifluoromethyl)-1,2,4-oxadiazol-3-yl)phenyl]methyl]propanamide, (15.098) 1-methoxy-3-methyl-1-[[4-[5-(trifluoromethyl)-1,2,4-oxadiazol-3-yl]phenyl]methyl]urea, (15.099) 1,3-dimethoxy-1-[[4-[5-(trifluoro-methyl)-1,2,4-oxadiazol-3-yl]phenyl]methyl]urea, (15.100) 3-ethyl-1-methoxy-1-[[4-[5-(trifluoromethyl)-1,2,4-oxadiazol-3-yl]phenyl]methyl]urea, (15.101) 1-[[4-[5-(trifluoromethyl)-1,2,4-oxadiazol-3-yl]phenyl]-methyl]piperidin-2-one, (15.102) 4,4-dimethyl-2-[[4-[5-(trifluoromethyl)-1,2,4-oxadiazol-3-yl]phenyl]-methyl]isooxazolidin-3-one, (15.103) 5,5-dimethyl-2-[[4-[5-(trifluoromethyl)-1,2,4-oxadiazol-3-yl]phenyl]methyl]isoxazolidin-3-one, (15.104) 3,3-dimethyl-1-[[4-[5-(trifluoromethyl)-1,2,4-oxadiazol-3-yl]phenyl]methyl]piperidin-2-one, (15.105) 1-[[3-fluoro-4-(5-(trifluoromethyl)-1,2,4-oxadiazol-3-yl]-phenyl]methyl]azepan-2-one, (15.106) 4,4-dimethyl-2-[[4-(5-(trifluoromethyl)-1,2,4-oxadiazol-3-yl]-phenyl]methyl]isoxazolidin-3-one, (15.107) 5,5-dimethyl-2-[[4-[5-(trifluoromethyl)-1,2,4-oxadiazol-3-yl]-phenyl]methyl]isoxazolidin-3-one, (15.108) ethyl 1-{4-[5-(trifluoromethyl)-1,2,4-oxadiazol-3-yl]benzyl}-1H-pyrazole-4-carboxylate, (15.109) N,N-dimethyl-1-{4-[5-(trifluoromethyl)-1,2,4-oxadiazol-3-yl]benzyl}-1H-1,2,4-triazol-3-amine, (15.110) N-{2,3-difluoro-4-[5-(trifluoromethyl)-1,2,4-oxadiazol-3-yl]benzyl}butanamide, (15.111) N-(1-methylcyclopropyl)-4-[5-(trifluoromethyl)-1,2,4-oxadiazol-3-yl]benzamide, (15.112) N-(2,4-difluorophenyl)-4-[5-(trifluoromethyl)-1,2,4-oxadiazol-3-yl]benzamide, (15.113) 1-(5,6-dimethylpyridin-3-yl)-4,4-difluoro-3,3-dimethyl-3,4-dihydroisoquinoline, (15.114) 1-(6-(difluoromethyl)-5-methyl-pyridin-3-yl)-4,4-difluoro-3,3-dimethyl-3,4-dihydroisoquinoline, (15.115) 1-(5-(fluoromethyl)-6-methyl-pyridin-3-yl)-4,4-difluoro-3,3-dimethyl-3,4-dihydroisoquinoline, (15.116) 1-(6-(difluoromethyl)-5-methoxy-pyridin-3-yl)-4,4-difluoro-3,3-dimethyl-3,4-dihydroisoquinoline, (15.117) 4-[5-(trifluoromethyl)-1,2,4-oxadiazol-3-yl]phenyl dimethylcarbamate, (15.118) N-{4-[5-(trifluoromethyl)-1,2,4-oxadiazol-3-yl]phenyl}propanamide, (15.119) 3-[2-(1-{[5-methyl-3-(trifluoromethyl)-1H-pyrazol-1-yl]acetyl}piperidin-4-yl)-1,3-thiazol-4-yl]-1,5-dihydro-2,4-benzodioxepin-6-yl methanesulfonate, (15.120) 9-fluoro-3-[2-(1-{[5-methyl-3-(trifluoromethyl)-1H-pyrazol-1-yl]acetyl}piperidin-4-yl)-1,3-thiazol-4-yl]-1,5-dihydro-2,4-benzodioxepin-6-yl methanesulfonate, (15.121) 3-[2-(1-{[3,5-bis(difluoromethyl)-1H-pyrazol-1-yl]acetyl}piperidin-4-yl)-1,3-thiazol-4-yl]-1,5-dihydro-2,4-benzodioxepin-6-yl methanesulfonate, (15.122) 3-[2-(1-{[3,5-bis(difluoromethyl)-1H-pyrazol-1-yl]acetyl}piperidin-4-yl)-1,3-thiazol-4-yl]-9-fluoro-1,5-dihydro-2,4-benzodioxepin-6-yl methanesulfonate, (15.123) 1-(6,7-dimethylpyrazolo[1,5-a]pyridin-3-yl)-4,4-difluoro-3,3-dimethyl-3,4-dihydroisoquinoline, (15.124) 8-fluoro-N-(4,4,4-trifluoro-2-methyl-1-phenylbutan-2-yl)quinoline-3-carboxamide, (15.125) 8-fluoro-N-[(2S)-4,4,4-trifluoro-2-methyl-1-phenylbutan-2-yl]quinoline-3-carboxamide, (15.126) N-(2,4-dimethyl-1-phenylpentan-2-yl)-8-fluoroquinoline-3-carboxamide and (15.127) N-[(2S)-2,4-dimethyl-1-phenylpentan-2-yl]-8-fluoro-quinoline-3-carboxamide, (15.128) D-tagatose,

antibacterial agents selected from the group consisting of bacteria, such as (16.001) Bacillus subtilis, in particular strain QST713/AQ713 (available as SERENADE OPTI or SERENADE ASO from Bayer CropScience LP, US, having NRRL Accession No. B21661 and described in U.S. Pat. No. 6,060,051); (16.002) Bacillus amyloliquefaciens, in particular strain D747 (available as Double Nickel™ from Certis, US, having accession number FERM BP-8234 and disclosed in U.S. Pat. No. 7,094,592); (16.003) Bacillus pumilus, in particular strain BU F-33 (having NRRL Accession No. 50185); (16.004) Bacillus subtilis var. amyloliquefaciens strain FZB24 (available as Taegro® from Novozymes, US); (16.005) a Paenibacillus sp. strain having Accession No. NRRL B-50972 or Accession No. NRRL B-67129 and described in International Patent Publication No. WO 2016/154297; and fungi, such as (16.006) Aureobasidium pullulans, in particular blastospores of strain DSM14940; (16.007) Aureobasidium pullulans blastospores of strain DSM 14941; (16.008) Aureobasidium pullulans, in particular mixtures of blastospores of strains DSM14940 and DSM14941,

biological fungicides selected from the group consisting of bacteria, for example (17.001) Bacillus subtilis, in particular strain QST713/AQ713 (available as SERENADE OPTI or SERENADE ASO from Bayer CropScience LP, US, having NRRL Accession No. B2166 land described in U.S. Pat. No. 6,060,051); (17.002) Bacillus pumilus, in particular strain QST2808 (available as SONATA® from Bayer CropScience LP, US, having Accession No. NRRL B-30087 and described in U.S. Pat. No. 6,245,551); (17.003) Bacillus pumilus, in particular strain GB34 (available as Yield Shield® from Bayer AG, DE); (17.004) Bacillus pumilus, in particular strain BU F-33 (having NRRL Accession No. 50185); (17.005) Bacillus amyloliquefaciens, in particular strain D747 (available as Double Nickel™ from Certis, US, having accession number FERM BP-8234 and disclosed in U.S. Pat. No. 7,094,592); (17.006) Bacillus subtilis Y1336 (available as BIOBAC® WP from Bion-Tech, Taiwan, registered as a biological fungicide in Taiwan under Registration Nos. 4764, 5454, 5096 and 5277); (17.007) Bacillus amyloliquefaciens strain MBI 600 (available as SUBTILEX from BASF SE); (17.008) Bacillus subtilis strain GB03 (available as Kodiak® from Bayer AG, DE); (17.009) Bacillus subtilis var. amyloliquefaciens strain FZB24 (available from Novozymes Biologicals Inc., Salem, Va. or Syngenta Crop Protection, LLC, Greensboro, N.C. as the fungicide TAEGRO® or TAEGRO® ECO (EPA Registration No. 70127-5); (17.010) Bacillus mycoides, isolate J (available as BmJ TGAI or WG from Certis USA); (17.011) Bacillus licheniformis, in particular strain SB3086 (available as EcoGuard™ Biofungicide and Green Releaf from Novozymes); (17.012) a Paenibacillus sp. strain having Accession No. NRRL B-50972 or Accession No. NRRL B-67129 and described in International Patent Publication No. WO 2016/154297,

fatty acids or derivatives, for example (18.001) a composition comprising one or more fatty acids or derivatives thereof selected from unsaturated and saturated C₁₂-C₂₄ fatty acids, salts thereof, esters thereof or mixtures of any of the foregoing, wherein at least 95% of said fatty acids or derivatives thereof are in the range of C₁₄ to C₂₀ (e.g. FLiPPER by AlphaBio Pesticides or Bayer AG).

Compound (B) is more preferably selected from:

(1.001) cyproconazole, (1.002) difenoconazole, (1.003) epoxiconazole, (1.004) fenhexamid, (1.010) imazalil, (1.012) ipconazole, (1.013) metconazole, (1.017) propiconazole, (1.018) prothioconazole, (1.020) spiroxamine, (1.021) tebuconazole, (1.026) (1R,2S,5S)-5-(4-chlorobenzyl)-2-(chloromethyl)-2-methyl-1-(1H-1,2,4-triazol-1-ylmethyl)cyclopentanol, (1.027) (1S,2R,5R)-5-(4-chlorobenzyl)-2-(chloromethyl)-2-methyl-1-(1H-1,2,4-triazol-1-ylmethyl)cyclopentanol, (1.055) mefentrifluconazole, (1.059) 5-(4-chlorobenzyl)-2-(chloromethyl)-2-methyl-1-(1H-1,2,4-triazol-1-ylmethyl)cyclopentanol, (1.081) ipfentrifluconazole, (1.082) 2-[6-(4-bromophenoxy)-2-(trifluoromethyl)-3-pyridyl]-1-(1,2,4-triazol-1-yl)propan-2-ol and (1.092) methyl 2-[2-chloro-4-(4-chlorophenoxy)phenyl]-2-hydroxy-3-(1,2,4-triazol-1-yl)propanoate

(2.001) benzovindiflupyr, (2.002) bixafen, (2.003) boscalid, (2.005) fluopyram, (2.007) fluxapyroxad, (2.009) isofetamid, (2.010) isopyrazam (anti-epimeric enantiomer 1R,4S,9S), (2.011) isopyrazam (anti-epimeric enantiomer 1S,4R,9R), (2.012) isopyrazam (anti-epimeric racemate 1RS,4SR,9SR), (2.013) isopyrazam (mixture of syn-epimeric racemate 1RS,4SR,9RS and anti-epimeric racemate 1RS,4SR,9SR), (2.014) isopyrazam (syn-epimeric enantiomer 1R,4S,9R), (2.015) isopyrazam (syn-epimeric enantiomer 1S,4R,9S), (2.016) isopyrazam (syn-epimeric racemate 1RS,4SR,9RS), (2.017) penflufen, (2.018) penthiopyrad, (2.019) pydiflumetofen, (2.021) sedaxane, (2.028) inpyrfluxam, (2.030) fluindapyr, (2.038) isoflucypram,

(3.003) azoxystrobin, (3.007) dimoxystrobin, (3.012) fluoxastrobin, (3.013) kresoxim-methyl, (3.016) picoxystrobin, (3.017) pyraclostrobin, (3.020) trifloxystrobin, (3.025) fenpicoxamid, (3.026) 2-{2-[(2,5-dimethylphenoxy)methyl]phenyl}-2-methoxy-N-methylacetamide, (3.030) metyltetraprole, (3.031) florylpicoxamid,

(4.005) pencycuron, (4.007) thiophanate-methyl, (4.012) 4-(2-bromo-4-fluorophenyl)-N-(2,6-difluorophenyl)-1,3-dimethyl-1H-pyrazol-5-amine, (4.015) 4-(2-bromo-4-fluorophenyl)-N-(2-chloro-6-fluorophenyl)-1,3-dimethyl-1H-pyrazol-5-amine, (4.025) N-(4-chloro-2,6-difluorophenyl)-4-(2-chloro-4-fluorophenyl)-1,3-dimethyl-1H-pyrazol-5-amine,

(5.003) captan, (5.004) chlorothalonil, (5.010), dithianon, (5.011) dodine, (5.012) folpet, (5.013) mancozeb, (5.015) metiram, (5.018) propineb,

(6.002) isotianil,

(7.001) cyprodinil, (7.005) pyrimethanil,

(12.003) metalaxyl, (12.004) metalaxyl-M (mefenoxam),

(13.001) fludioxonil, (13.002) iprodione, (13.004) proquinazid, (13.005) quinoxyfen,

(14.001) fluazinam, (14.002) meptyldinocap,

(15.008) cyflufenamid, (15.010) cyprosulfamide, (15.011) flutianil, (15.012) fosetyl-aluminium, (15.016) metrafenone, (15.027) pyriofenone (chlazafenone), (15.047) 3-(4,4-difluoro-3,3-dimethyl-3,4-dihydroisoquinolin-1-yl)quinolone, (15.048) 4-amino-5-fluoropyrimidin-2-ol (tautomeric form: 4-amino-5-fluoropyrimidin-2(1H)-one), (15.052) 5-fluoro-2-[(4-fluorobenzyl)oxy]pyrimidin-4-amine, (15.053) 5-fluoro-2-[(4-methylbenzyl)oxy]pyrimidin-4-amine, (15.062) 5-fluoro-4-imino-3-methyl-1-[(4-methylphenyl)sulfonyl]-3,4-dihydropyrimidin-2(1H)-one, (15.063) aminopyrifen, (15.064) (N′-[2-chloro-4-(2-fluorophenoxy)-5-methylphenyl]-N-ethyl-N-methylimidoformamide),

(16.001) Bacillus subtilis, in particular strain QST713/AQ713 (available as SERENADE OPTI or SERENADE ASO from Bayer CropScience LP, US, having NRRL Accession No. B21661 and described in U.S. Pat. No. 6,060,051),

(17.001) Bacillus subtilis, in particular strain QST713/AQ713 (available as SERENADE OPTI or SERENADE ASO from Bayer CropScience LP, US, having NRRL Accession No. B21661 and described in U.S. Pat. No. 6,060,051); (17.002) Bacillus pumilus, in particular strain QST2808 (available as SONATA® from Bayer CropScience LP, US, having Accession No. NRRL B-30087 and described in U.S. Pat. No. 6,245,551); (17.003) Bacillus pumilus, in particular strain GB34 (available as Yield Shield® from Bayer AG, DE); (17.008) Bacillus subtilis strain GB03 (available as Kodiak® from Bayer AG, DE); (17.009) Bacillus subtilis var. amyloliquefaciens strain FZB24 (available from Novozymes Biologicals Inc., Salem, Va. or Syngenta Crop Protection, LLC, Greensboro, N.C. as the fungicide TAEGRO® or TAEGRO® ECO (EPA Registration No. 70127-5); (17.011) Bacillus licheniformis, in particular strain SB3086 (available as EcoGuard™ Biofungicide and Green Releaf from Novozymes); (17.012) a Paenibacillus sp. strain having Accession No. NRRL B-50972 or Accession No. NRRL B-67129 and described in International Patent Publication No. WO 2016/154297,

(18.001) a composition comprising one or more fatty acids or derivatives thereof selected from unsaturated and saturated C₁₂-C₂₄ fatty acids, salts thereof, esters thereof or mixtures of any of the foregoing, wherein at least 95% of said fatty acids or derivatives thereof are in the range of C₁₄ to C₂₀ (e.g. FLiPPER by AlphaBio Pesticides or Bayer AG).

Compound (B) is even more preferably selected from:

(1.002) difenoconazole, (1.004) fenhexamid, (1.010) imazalil, (1.012) ipconazole, (1.018) prothioconazole, (1.020) spiroxamine, (1.021) tebuconazole, (1.026) (1R,2S,5S)-5-(4-chlorobenzyl)-2-(chloromethyl)-2-methyl-1-(1H-1,2,4-triazol-1-ylmethyl)cyclopentanol, (1.027) (1S,2R,5R)-5-(4-chlorobenzyl)-2-(chloromethyl)-2-methyl-1-(1H-1,2,4-triazol-1-ylmethyl)cyclopentanol, (1.055) mefentrifluconazole, (1.059) 5-(4-chlorobenzyl)-2-(chloromethyl)-2-methyl-1-(1H-1,2,4-triazol-1-ylmethyl)cyclopentanol, (1.081) ipfentrifluconazole, (1.082) 2-[6-(4-bromophenoxy)-2-(trifluoromethyl)-3-pyridyl]-1-(1,2,4-triazol-1-yl)propan-2-ol and (1.092) methyl 2-[2-chloro-4-(4-chlorophenoxy)phenyl]-2-hydroxy-3-(1,2,4-triazol-1-yl)propanoate

(2.001) benzovindiflupyr, (2.002) bixafen, (2.003) boscalid, (2.005) fluopyram, (2.007) fluxapyroxad, (2.017) penflufen, (2.018) penthiopyrad, (2.019) pydiflumetofen, (2.021) sedaxane, (2.028) inpyrfluxam, (2.030) fluindapyr, (2.038) isoflucypram,

(3.003) azoxystrobin, (3.012) fluoxastrobin, (3.016) picoxystrobin, (3.017) pyraclostrobin, (3.020) trifloxystrobin, (3.025) fenpicoxamid, (3.026) 2-{2-[(2,5-dimethylphenoxy)methyl]phenyl}-2-methoxy-N-methylacetamide, (3.030) metyltetraprole, (3.031) florylpicoxamid,

(4.005) pencycuron, (4.007) thiophanate-methyl, (4.012) 4-(2-bromo-4-fluorophenyl)-N-(2,6-difluoro-phenyl)-1,3-dimethyl-1H-pyrazol-5-amine, (4.015) 4-(2-bromo-4-fluorophenyl)-N-(2-chloro-6-fluoro-phenyl)-1,3-dimethyl-1H-pyrazol-5-amine, (4.025) N-(4-chloro-2,6-difluorophenyl)-4-(2-chloro-4-fluoro-phenyl)-1,3-dimethyl-1H-pyrazol-5-amine,

(5.003) captan, (5.004) chlorothalonil, (5.010), dithianon, (5.012) folpet, (5.013) mancozeb, (5.015) metiram, (5.018) propineb,

(6.002) isotianil,

(7.005) pyrimethanil,

(12.003) metalaxyl, (12.004) metalaxyl-M (mefenoxam),

(13.001) fludioxonil, (13.004) proquinazid, (13.005) quinoxyfen,

(14.001) fluazinam, (14.002) meptyldinocap,

(15.008) cyflufenamid, (15.012) fosetyl-aluminium, (15.016) metrafenone, (15.027) pyriofenone (chlazafenone), (15.047) 3-(4,4-difluoro-3,3-dimethyl-3,4-dihydroisoquinolin-1-yl)quinolone, (15.048) 4-amino-5-fluoropyrimidin-2-ol (tautomeric form: 4-amino-5-fluoropyrimidin-2(1H)-one), (15.052) 5-fluoro-2[(4-fluorobenzyl)oxy]pyrimidin-4-amine, (15.062) 5-fluoro-4-imino-3-methyl-1-[(4-methyl-phenyl)sulfonyl]-3,4-dihydropyrimidin-2(1H)-one, (15.064) (N-[2-chloro-4-(2-fluorophenoxy)-5-methylphenyl]-N-ethyl-N-methylimidoformamide),

(16.001) Bacillus subtilis, in particular strain QST713/AQ713 (available as SERENADE OPTI or SERENADE ASO from Bayer CropScience LP, US, having NRRL Accession No. B21661 and described in U.S. Pat. No. 6,060,051),

(17.001) Bacillus subtilis, in particular strain QST713/AQ713 (available as SERENADE OPTI or SERENADE ASO from Bayer CropScience LP, US, having NRRL Accession No. B21661 and described in U.S. Pat. No. 6,060,051); (17.012) a Paenibacillus sp. strain having Accession No. NRRL B-50972 or Accession No. NRRL B-67129 and described in International Patent Publication No. WO 2016/154297,

(18.001) a composition comprising one or more fatty acids or derivatives thereof selected from unsaturated and saturated C₁₂-C₂₄ fatty acids, salts thereof, esters thereof or mixtures of any of the foregoing, wherein at least 95% of said fatty acids or derivatives thereof are in the range of C₁₄ to C₂₀ (e.g. FLiPPER by AlphaBio Pesticides or Bayer AG).

Compound (B) is most preferably selected from (with Data):

(1.002) difenoconazole, (1.018) prothioconazole, (1.020) spiroxamine, (1.021) tebuconazole, (1.055) mefentrifluconazole

(2.002) bixafen, (2.005) fluopyram, (2.028) inpyrfluxam, (2.038) isoflucypram,

(3.020) trifloxystrobin, (3.025) fenpicoxamid,

(5.003) captan, (5.010) dithianon, (5.012) folpet, (5.013) mancozeb, (5.018) propineb,

(6.002) isotianil,

(7.005) pyrimethanil,

(13.001) fludioxonil, (13.004) proquinazid, (13.005) quinoxyfen,

(15.012) fosetyl-aluminium, (15.016) metrafenone and (15.064) (N′-[2-chloro-4-(2-fluorophenoxy)-5-methylphenyl]-N-ethyl-N-methylimidoformamide),

(18.001) a composition comprising one or more fatty acids or derivatives thereof selected from unsaturated and saturated C₁₂-C₂₄ fatty acids, salts thereof, esters thereof or mixtures of any of the foregoing, wherein at least 95% of said fatty acids or derivatives thereof are in the range of C₁₄ to C₂₀ (e.g. FLiPPER by AlphaBio Pesticides or Bayer AG).

The compound combinations according to the invention may comprise 1, 2 or even more compounds (B).

Preferably, the compound combinations according to the invention comprise 1 or 2 compound(s) (B).

In case two or more compound(s) (B) are present, those compounds may be selected from different groups (1) to (18). For example, if one compound (B) is selected from group (1), the further compound(s) (B) may be selected from groups (2) to (18).

Preferred compound combinations are selected from group (G1) consisting of the following mixtures:

(I-655)+(1.001), (I-655)+(1.002), (I-655)+(1.003), (I-655)+(1.004), (I-655)+(1.005), (I-655)+(1.006), (I-655)+(1.007), (I-655)+(1.008), (I-655)+(1.009), (I-655)+(1.010), (I-655)+(1.011), (I-655)+(1.012), (I-655)+(1.013), (I-655)+(1.014), (I-655)+(1.015), (I-655)+(1.016), (I-655)+(1.017), (I-655)+(1.018), (I-655)+(1.019), (I-655)+(1.020), (I-655)+(1.021), (I-655)+(1.022), (I-655)+(1.023), (I-655)+(1.024), (I-655)+(1.025), (I-655)+(1.026), (I-655)+(1.027), (I-655)+(1.028), (I-655)+(1.029), (I-655)+(1.030), (I-655)+(1.031), (I-655)+(1.032), (I-655)+(1.033), (I-655)+(1.034), (I-655)+(1.035), (I-655)+(1.036), (I-655)+(1.037), (I-655)+(1.038), (I-655)+(1.039), (I-655)+(1.040), (I-655)+(1.041), (I-655)+(1.042), (I-655)+(1.043), (I-655)+(1.044), (I-655)+(1.045), (I-655)+(1.046), (I-655)+(1.047), (I-655)+(1.048), (I-655)+(1.049), (I-655)+(1.050), (I-655)+(1.051), (I-655)+(1.052), (I-655)+(1.053), (I-655)+(1.054), (I-655)+(1.055), (I-655)+(1.056), (I-655)+(1.057), (I-655)+(1.058), (I-655)+(1.059), (I-655)+(1.060), (I-655)+(1.061), (I-655)+(1.062), (I-655)+(1.063), (I-655)+(1.064), (I-655)+(1.065), (I-655)+(1.066), (I-655)+(1.067), (I-655)+(1.068), (I-655)+(1.069), (I-655)+(1.070), (I-655)+(1.071), (I-655)+(1.072), (I-655)+(1.073), (I-655)+(1.074), (I-655)+(1.075), (I-655)+(1.076), (I-655)+(1.077), (I-655)+(1.078), (I-655)+(1.079), (I-655)+(1.080), (I-655)+(1.081), (I-655)+(1.082), (I-655)+(1.083), (I-655)+(1.084), (I-655)+(1.085), (I-655)+(1.086), (I-655)+(1.087), (I-655)+(1.088), (I-655)+(1.089), (I-655)+(1.090), (I-655)+(1.091), (I-655)+(1.092), (I-655)+(2.001), (I-655)+(2.002), (I-655)+(2.003), (I-655)+(2.004), (I-655)+(2.005), (I-655)+(2.006), (I-655)+(2.007), (I-655)+(2.008), (I-655)+(2.009), (I-655)+(2.010), (I-655)+(2.011), (I-655)+(2.012), (I-655)+(2.013), (I-655)+(2.014), (I-655)+(2.015), (I-655)+(2.016), (I-655)+(2.017), (I-655)+(2.018), (I-655)+(2.019), (I-655)+(2.020), (I-655)+(2.021), (I-655)+(2.022), (I-655)+(2.023), (I-655)+(2.024), (I-655)+(2.025), (I-655)+(2.026), (I-655)+(2.027), (I-655)+(2.028), (I-655)+(2.029), (I-655)+(2.030), (I-655)+(2.031), (I-655)+(2.032), (I-655)+(2.033), (I-655)+(2.034), (I-655)+(2.035), (I-655)+(2.036), (I-655)+(2.037), (I-655)+(2.038), (I-655)+(2.039), (I-655)+(2.040), (I-655)+(2.041), (I-655)+(2.042), (I-655)+(2.043), (I-655)+(2.044), (I-655)+(2.045), (I-655)+(2.046), (I-655)+(2.047), (I-655)+(2.048), (I-655)+(2.049), (I-655)+(2.050), (I-655)+(2.051), (I-655)+(2.052), (I-655)+(2.053), (I-655)+(2.054), (I-655)+(2.055), (I-655)+(2.056), (I-655)+(2.057), (I-655)+(2.058), (I-655)+(2.059), (I-655)+(2.060), (I-655)+(3.001), (I-655)+(3.002), (I-655)+(3.003), (I-655)+(3.004), (I-655)+(3.005), (I-655)+(3.006), (I-655)+(3.007), (I-655)+(3.008), (I-655)+(3.009), (I-655)+(3.010), (I-655)+(3.011), (I-655)+(3.012), (I-655)+(3.013), (I-655)+(3.014), (I-655)+(3.015), (I-655)+(3.016), (I-655)+(3.017), (I-655)+(3.018), (I-655)+(3.019), (I-655)+(3.020), (I-655)+(3.021), (I-655)+(3.022), (I-655)+(3.023), (I-655)+(3.024), (I-655)+(3.025), (I-655)+(3.026), (I-655)+(3.027), (I-655)+(3.028), (I-655)+(3.029), (I-655)+(3.030), (I-655)+(3.031), (I-655)+(3.032), (I-655)+(4.001), (I-655)+(4.002), (I-655)+(4.003), (I-655)+(4.004), (I-655)+(4.005), (I-655)+(4.006), (I-655)+(4.007), (I-655)+(4.008), (I-655)+(4.009), (I-655)+(4.010), (I-655)+(4.011), (I-655)+(4.012), (I-655)+(4.013), (I-655)+(4.014), (I-655)+(4.015), (I-655)+(4.016), (I-655)+(4.017), (I-655)+(4.018), (I-655)+(4.019), (I-655)+(4.020), (I-655)+(4.021), (I-655)+(4.022), (I-655)+(4.023), (I-655)+(4.024), (I-655)+(4.025), (I-655)+(4.026), (I-655)+(5.001), (I-655)+(5.002), (I-655)+(5.003), (I-655)+(5.004), (I-655)+(5.005), (I-655)+(5.006), (I-655)+(5.007), (I-655)+(5.008), (I-655)+(5.009), (I-655)+(5.010), (I-655)+(5.011), (I-655)+(5.012), (I-655)+(5.013), (I-655)+(5.014), (I-655)+(5.015), (I-655)+(5.016), (I-655)+(5.017), (I-655)+(5.018), (I-655)+(5.019), (I-655)+(5.020), (I-655)+(5.021), (I-655)+(5.022), (I-655)+(5.023), (I-655)+(6.001), (I-655)+(6.002), (I-655)+(6.003), (I-655)+(6.004), (I-655)+(7.001), (I-655)+(7.002), (I-655)+(7.003), (I-655)+(7.004), (I-655)+(7.005), (I-655)+(7.006), (I-655)+(8.001), (I-655)+(9.001), (I-655)+(9.002), (I-655)+(9.003), (I-655)+(9.004), (I-655)+(9.005), (I-655)+(9.006), (I-655)+(9.007), (I-655)+(9.008), (I-655)+(9.009), (I-655)+(10.001), (I-655)+(10.002), (I-655)+(10.003), (I-655)+(11.001), (I-655)+(11.002), (I-655)+(12.001), (I-655)+(12.002), (I-655)+(12.003), (I-655)+(12.004), (I-655)+(13.001), (I-655)+(13.002), (I-655)+(13.003), (I-655)+(13.004), (I-655)+(13.005), (I-655)+(13.006), (I-655)+(14.001), (I-655)+(14.002), (I-655)+(15.001), (I-655)+(15.002), (I-655)+(15.003), (I-655)+(15.004), (I-655)+(15.005), (I-655)+(15.006), (I-655)+(15.007), (I-655)+(15.008), (I-655)+(15.009), (I-655)+(15.010), (I-655)+(15.011), (I-655)+(15.012), (I-655)+(15.013), (I-655)+(15.014), (I-655)+(15.015), (I-655)+(15.016), (I-655)+(15.017), (I-655)+(15.018), (I-655)+(15.019), (I-655)+(15.020), (I-655)+(15.021), (I-655)+(15.022), (I-655)+(15.023), (I-655)+(15.024), (I-655)+(15.025), (I-655)+(15.026), (I-655)+(15.027), (I-655)+(15.028), (I-655)+(15.029), (I-655)+(15.030), (I-655)+(15.031), (I-655)+(15.032), (I-655)+(15.033), (I-655)+(15.034), (I-655)+(15.035), (I-655)+(15.036), (I-655)+(15.037), (I-655)+(15.038), (I-655)+(15.039), (I-655)+(15.040), (I-655)+(15.041), (I-655)+(15.042), (I-655)+(15.043), (I-655)+(15.044), (I-655)+(15.045), (I-655)+(15.046), (I-655)+(15.047), (I-655)+(15.048), (I-655)+(15.049), (I-655)+(15.050), (I-655)+(15.051), (I-655)+(15.052), (I-655)+(15.053), (I-655)+(15.054), (I-655)+(15.055), (I-655)+(15.056), (I-655)+(15.057), (I-655)+(15.058), (I-655)+(15.059), (I-655)+(15.060), (I-655)+(15.061), (I-655)+(15.062), (I-655)+(15.063), (I-655)+(15.064), (I-655)+(15.065), (I-655)+(15.066), (I-655)+(15.067), (I-655)+(15.068), (I-655)+(15.069), (I-655)+(15.070), (I-655)+(15.071), (I-655)+(15.072), (I-655)+(15.073), (I-655)+(15.074), (I-655)+(15.075), (I-655)+(15.076), (I-655)+(15.077), (I-655)+(15.078), (I-655)+(15.079), (I-655)+(15.080), (I-655)+(15.081), (I-655)+(15.082), (I-655)+(15.083), (I-655)+(15.084), (I-655)+(15.085), (I-655)+(15.086), (I-655)+(15.087), (I-655)+(15.088), (I-655)+(15.089), (I-655)+(15.090), (I-655)+(15.091), (I-655)+(15.092), (I-655)+(15.093), (I-655)+(15.094), (I-655)+(15.095), (I-655)+(15.096), (I-655)+(15.097), (I-655)+(15.098), (I-655)+(15.099), (I-655)+(15.100), (I-655)+(15.101), (I-655)+(15.102), (I-655)+(15.103), (I-655)+(15.104), (I-655)+(15.105), (I-655)+(15.106), (I-655)+(15.107), (I-655)+(15.108), (I-655)+(15.109), (I-655)+(15.110), (I-655)+(15.111), (I-655)+(15.112), (I-655)+(15.113), (I-655)+(15.114), (I-655)+(15.115), (I-655)+(15.116), (I-655)+(15.117), (I-655)+(15.118), (I-655)+(15.119), (I-655)+(15.120), (I-655)+(15.121), (I-655)+(15.122), (I-655)+(15.123), (I-655)+(15.124), (I-655)+(15.125), (I-655)+(15.126), (I-655)+(15.127), (I-655)+(15.128), (I-655)+(16.001), (I-655)+(16.002), (I-655)+(16.003), (I-655)+(16.004), (I-655)+(16.005), (I-655)+(16.006), (I-655)+(16.007), (I-655)+(16.008), (I-655)+(17.001), (I-655)+(17.002), (I-655)+(17.003), (I-655)+(17.004), (I-655)+(17.005), (I-655)+(17.006), (I-655)+(17.007), (I-655)+(17.008), (I-655)+(17.009), (I-655)+(17.010), (I-655)+(17.011), (I-655)+(17.012) and (I-655)+(18.001).

Also preferred compound combinations are selected from group (G2) consisting of the following mixtures:

(I-667)+(1.001), (I-667)+(1.002), (I-667)+(1.003), (I-667)+(1.004), (I-667)+(1.005), (I-667)+(1.006), (I-667)+(1.007), (I-667)+(1.008), (I-667)+(1.009), (I-667)+(1.010), (I-667)+(1.011), (I-667)+(1.012), (I-667)+(1.013), (I-667)+(1.014), (I-667)+(1.015), (I-667)+(1.016), (I-667)+(1.017), (I-667)+(1.018), (I-667)+(1.019), (I-667)+(1.020), (I-667)+(1.021), (I-667)+(1.022), (I-667)+(1.023), (I-667)+(1.024), (I-667)+(1.025), (I-667)+(1.026), (I-667)+(1.027), (I-667)+(1.028), (I-667)+(1.029), (I-667)+(1.030), (I-667)+(1.031), (I-667)+(1.032), (I-667)+(1.033), (I-667)+(1.034), (I-667)+(1.035), (I-667)+(1.036), (I-667)+(1.037), (I-667)+(1.038), (I-667)+(1.039), (I-667)+(1.040), (I-667)+(1.041), (I-667)+(1.042), (I-667)+(1.043), (I-667)+(1.044), (I-667)+(1.045), (I-667)+(1.046), (I-667)+(1.047), (I-667)+(1.048), (I-667)+(1.049), (I-667)+(1.050), (I-667)+(1.051), (I-667)+(1.052), (I-667)+(1.053), (I-667)+(1.054), (I-667)+(1.055), (I-667)+(1.056), (I-667)+(1.057), (I-667)+(1.058), (I-667)+(1.059), (I-667)+(1.060), (I-667)+(1.061), (I-667)+(1.062), (I-667)+(1.063), (I-667)+(1.064), (I-667)+(1.065), (I-667)+(1.066), (I-667)+(1.067), (I-667)+(1.068), (I-667)+(1.069), (I-667)+(1.070), (I-667)+(1.071), (I-667)+(1.072), (I-667)+(1.073), (I-667)+(1.074), (I-667)+(1.075), (I-667)+(1.076), (I-667)+(1.077), (I-667)+(1.078), (I-667)+(1.079), (I-667)+(1.080), (I-667)+(1.081), (I-667)+(1.082), (I-667)+(1.083), (I-667)+(1.084), (I-667)+(1.085), (I-667)+(1.086), (I-667)+(1.087), (I-667)+(1.088), (I-667)+(1.089), (I-667)+(1.090), (I-667)+(1.091), (I-667)+(1.092), (I-667)+(2.001), (I-667)+(2.002), (I-667)+(2.003), (I-667)+(2.004), (I-667)+(2.005), (I-667)+(2.006), (I-667)+(2.007), (I-667)+(2.008), (I-667)+(2.009), (I-667)+(2.010), (I-667)+(2.011), (I-667)+(2.012), (I-667)+(2.013), (I-667)+(2.014), (I-667)+(2.015), (I-667)+(2.016), (I-667)+(2.017), (I-667)+(2.018), (I-667)+(2.019), (I-667)+(2.020), (I-667)+(2.021), (I-667)+(2.022), (I-667)+(2.023), (I-667)+(2.024), (I-667)+(2.025), (I-667)+(2.026), (I-667)+(2.027), (I-667)+(2.028), (I-667)+(2.029), (I-667)+(2.030), (I-667)+(2.031), (I-667)+(2.032), (I-667)+(2.033), (I-667)+(2.034), (I-667)+(2.035), (I-667)+(2.036), (I-667)+(2.037), (I-667)+(2.038), (I-667)+(2.039), (I-667)+(2.040), (I-667)+(2.041), (I-667)+(2.042), (I-667)+(2.043), (I-667)+(2.044), (I-667)+(2.045), (I-667)+(2.046), (I-667)+(2.047), (I-667)+(2.048), (I-667)+(2.049), (I-667)+(2.050), (I-667)+(2.051), (I-667)+(2.052), (I-667)+(2.053), (I-667)+(2.054), (I-667)+(2.055), (I-667)+(2.056), (I-667)+(2.057), (I-667)+(2.058), (I-667)+(2.059), (I-667)+(2.060), (I-667)+(3.001), (I-667)+(3.002), (I-667)+(3.003), (I-667)+(3.004), (I-667)+(3.005), (I-667)+(3.006), (I-667)+(3.007), (I-667)+(3.008), (I-667)+(3.009), (I-667)+(3.010), (I-667)+(3.011), (I-667)+(3.012), (I-667)+(3.013), (I-667)+(3.014), (I-667)+(3.015), (I-667)+(3.016), (I-667)+(3.017), (I-667)+(3.018), (I-667)+(3.019), (I-667)+(3.020), (I-667)+(3.021), (I-667)+(3.022), (I-667)+(3.023), (I-667)+(3.024), (I-667)+(3.025), (I-667)+(3.026), (I-667)+(3.027), (I-667)+(3.028), (I-667)+(3.029), (I-667)+(3.030), (I-667)+(3.031), (I-667)+(3.032), (I-667)+(4.001), (I-667)+(4.002), (I-667)+(4.003), (I-667)+(4.004), (I-667)+(4.005), (I-667)+(4.006), (I-667)+(4.007), (I-667)+(4.008), (I-667)+(4.009), (I-667)+(4.010), (I-667)+(4.011), (I-667)+(4.012), (I-667)+(4.013), (I-667)+(4.014), (I-667)+(4.015), (I-667)+(4.016), (I-667)+(4.017), (I-667)+(4.018), (I-667)+(4.019), (I-667)+(4.020), (I-667)+(4.021), (I-667)+(4.022), (I-667)+(4.023), (I-667)+(4.024), (I-667)+(4.025), (I-667)+(4.026), (I-667)+(5.001), (I-667)+(5.002), (I-667)+(5.003), (I-667)+(5.004), (I-667)+(5.005), (I-667)+(5.006), (I-667)+(5.007), (I-667)+(5.008), (I-667)+(5.009), (I-667)+(5.010), (I-667)+(5.011), (I-667)+(5.012), (I-667)+(5.013), (I-667)+(5.014), (I-667)+(5.015), (I-667)+(5.016), (I-667)+(5.017), (I-667)+(5.018), (I-667)+(5.019), (I-667)+(5.020), (I-667)+(5.021), (I-667)+(5.022), (I-667)+(5.023), (I-667)+(6.001), (I-667)+(6.002), (I-667)+(6.003), (I-667)+(6.004), (I-667)+(7.001), (I-667)+(7.002), (I-667)+(7.003), (I-667)+(7.004), (I-667)+(7.005), (I-667)+(7.006), (I-667)+(8.001), (I-667)+(9.001), (I-667)+(9.002), (I-667)+(9.003), (I-667)+(9.004), (I-667)+(9.005), (I-667)+(9.006), (I-667)+(9.007), (I-667)+(9.008), (I-667)+(9.009), (I-667)+(10.001), (I-667)+(10.002), (I-667)+(10.003), (I-667)+(11.001), (I-667)+(11.002), (I-667)+(12.001), (I-667)+(12.002), (I-667)+(12.003), (I-667)+(12.004), (I-667)+(13.001), (I-667)+(13.002), (I-667)+(13.003), (I-667)+(13.004), (I-667)+(13.005), (I-667)+(13.006), (I-667)+(14.001), (I-667)+(14.002), (I-667)+(15.001), (I-667)+(15.002), (I-667)+(15.003), (I-667)+(15.004), (I-667)+(15.005), (I-667)+(15.006), (I-667)+(15.007), (I-667)+(15.008), (I-667)+(15.009), (I-667)+(15.010), (I-667)+(15.011), (I-667)+(15.012), (I-667)+(15.013), (I-667)+(15.014), (I-667)+(15.015), (I-667)+(15.016), (I-667)+(15.017), (I-667)+(15.018), (I-667)+(15.019), (I-667)+(15.020), (I-667)+(15.021), (I-667)+(15.022), (I-667)+(15.023), (I-667)+(15.024), (I-667)+(15.025), (I-667)+(15.026), (I-667)+(15.027), (I-667)+(15.028), (I-667)+(15.029), (I-667)+(15.030), (I-667)+(15.031), (I-667)+(15.032), (I-667)+(15.033), (I-667)+(15.034), (I-667)+(15.035), (I-667)+(15.036), (I-667)+(15.037), (I-667)+(15.038), (I-667)+(15.039), (I-667)+(15.040), (I-667)+(15.041), (I-667)+(15.042), (I-667)+(15.043), (I-667)+(15.044), (I-667)+(15.045), (I-667)+(15.046), (I-667)+(15.047), (I-667)+(15.048), (I-667)+(15.049), (I-667)+(15.050), (I-667)+(15.051), (I-667)+(15.052), (I-667)+(15.053), (I-667)+(15.054), (I-667)+(15.055), (I-667)+(15.056), (I-667)+(15.057), (I-667)+(15.058), (I-667)+(15.059), (I-667)+(15.060), (I-667)+(15.061), (I-667)+(15.062), (I-667)+(15.063), (I-667)+(15.064), (I-667)+(15.065), (I-667)+(15.066), (I-667)+(15.067), (I-667)+(15.068), (I-667)+(15.069), (I-667)+(15.070), (I-667)+(15.071), (I-667)+(15.072), (I-667)+(15.073), (I-667)+(15.074), (I-667)+(15.075), (I-667)+(15.076), (I-667)+(15.077), (I-667)+(15.078), (I-667)+(15.079), (I-667)+(15.080), (I-667)+(15.081), (I-667)+(15.082), (I-667)+(15.083), (I-667)+(15.084), (I-667)+(15.085), (I-667)+(15.086), (I-667)+(15.087), (I-667)+(15.088), (I-667)+(15.089), (I-667)+(15.090), (I-667)+(15.091), (I-667)+(15.092), (I-667)+(15.093), (I-667)+(15.094), (I-667)+(15.095), (I-667)+(15.096), (I-667)+(15.097), (I-667)+(15.098), (I-667)+(15.099), (I-667)+(15.100), (I-667)+(15.101), (I-667)+(15.102), (I-667)+(15.103), (I-667)+(15.104), (I-667)+(15.105), (I-667)+(15.106), (I-667)+(15.107), (I-667)+(15.108), (I-667)+(15.109), (I-667)+(15.110), (I-667)+(15.111), (I-667)+(15.112), (I-667)+(15.113), (I-667)+(15.114), (I-667)+(15.115), (I-667)+(15.116), (I-667)+(15.117), (I-667)+(15.118), (I-667)+(15.119), (I-667)+(15.120), (I-667)+(15.121), (I-667)+(15.122), (I-667)+(15.123), (I-667)+(15.124), (I-667)+(15.125), (I-667)+(15.126), (I-667)+(15.127), (I-667)+(15.128), (I-667)+(16.001), (I-667)+(16.002), (I-667)+(16.003), (I-667)+(16.004), (I-667)+(16.005), (I-667)+(16.006), (I-667)+(16.007), (I-667)+(16.008), (I-667)+(17.001), (I-667)+(17.002), (I-667)+(17.003), (I-667)+(17.004), (I-667)+(17.005), (I-667)+(17.006), (I-667)+(17.007), (I-667)+(17.008), (I-667)+(17.009), (I-667)+(17.010), (I-667)+(17.011), (I-667)+(17.012) and (I-667)+(18.001).

Also preferred compound combinations are selected from group (G3) consisting of the following mixtures:

(I-746)+(1.001), (I-746)+(1.002), (I-746)+(1.003), (I-746)+(1.004), (I-746)+(1.005), (I-746)+(1.006), (I-746)+(1.007), (I-746)+(1.008), (I-746)+(1.009), (I-746)+(1.010), (I-746)+(1.011), (I-746)+(1.012), (I-746)+(1.013), (I-746)+(1.014), (I-746)+(1.015), (I-746)+(1.016), (I-746)+(1.017), (I-746)+(1.018), (I-746)+(1.019), (I-746)+(1.020), (I-746)+(1.021), (I-746)+(1.022), (I-746)+(1.023), (I-746)+(1.024), (I-746)+(1.025), (I-746)+(1.026), (I-746)+(1.027), (I-746)+(1.028), (I-746)+(1.029), (I-746)+(1.030), (I-746)+(1.031), (I-746)+(1.032), (I-746)+(1.033), (I-746)+(1.034), (I-746)+(1.035), (I-746)+(1.036), (I-746)+(1.037), (I-746)+(1.038), (I-746)+(1.039), (I-746)+(1.040), (I-746)+(1.041), (I-746)+(1.042), (I-746)+(1.043), (I-746)+(1.044), (I-746)+(1.045), (I-746)+(1.046), (I-746)+(1.047), (I-746)+(1.048), (I-746)+(1.049), (I-746)+(1.050), (I-746)+(1.051), (I-746)+(1.052), (I-746)+(1.053), (I-746)+(1.054), (I-746)+(1.055), (I-746)+(1.056), (I-746)+(1.057), (I-746)+(1.058), (I-746)+(1.059), (I-746)+(1.060), (I-746)+(1.061), (I-746)+(1.062), (I-746)+(1.063), (I-746)+(1.064), (I-746)+(1.065), (I-746)+(1.066), (I-746)+(1.067), (I-746)+(1.068), (I-746)+(1.069), (I-746)+(1.070), (I-746)+(1.071), (I-746)+(1.072), (I-746)+(1.073), (I-746)+(1.074), (I-746)+(1.075), (I-746)+(1.076), (I-746)+(1.077), (I-746)+(1.078), (I-746)+(1.079), (I-746)+(1.080), (I-746)+(1.081), (I-746)+(1.082), (I-746)+(1.083), (I-746)+(1.084), (I-746)+(1.085), (I-746)+(1.086), (I-746)+(1.087), (I-746)+(1.088), (I-746)+(1.089), (I-746)+(1.090), (I-746)+(1.091), (I-746)+(1.092), (I-746)+(2.001), (I-746)+(2.002), (I-746)+(2.003), (I-746)+(2.004), (I-746)+(2.005), (I-746)+(2.006), (I-746)+(2.007), (I-746)+(2.008), (I-746)+(2.009), (I-746)+(2.010), (I-746)+(2.011), (I-746)+(2.012), (I-746)+(2.013), (I-746)+(2.014), (I-746)+(2.015), (I-746)+(2.016), (I-746)+(2.017), (I-746)+(2.018), (I-746)+(2.019), (I-746)+(2.020), (I-746)+(2.021), (I-746)+(2.022), (I-746)+(2.023), (I-746)+(2.024), (I-746)+(2.025), (I-746)+(2.026), (I-746)+(2.027), (I-746)+(2.028), (I-746)+(2.029), (I-746)+(2.030), (I-746)+(2.031), (I-746)+(2.032), (I-746)+(2.033), (I-746)+(2.034), (I-746)+(2.035), (I-746)+(2.036), (I-746)+(2.037), (I-746)+(2.038), (I-746)+(2.039), (I-746)+(2.040), (I-746)+(2.041), (I-746)+(2.042), (I-746)+(2.043), (I-746)+(2.044), (I-746)+(2.045), (I-746)+(2.046), (I-746)+(2.047), (I-746)+(2.048), (I-746)+(2.049), (I-746)+(2.050), (I-746)+(2.051), (I-746)+(2.052), (I-746)+(2.053), (I-746)+(2.054), (I-746)+(2.055), (I-746)+(2.056), (I-746)+(2.057), (I-746)+(2.058), (I-746)+(2.059), (I-746)+(2.060), (I-746)+(3.001), (I-746)+(3.002), (I-746)+(3.003), (I-746)+(3.004), (I-746)+(3.005), (I-746)+(3.006), (I-746)+(3.007), (I-746)+(3.008), (I-746)+(3.009), (I-746)+(3.010), (I-746)+(3.011), (I-746)+(3.012), (I-746)+(3.013), (I-746)+(3.014), (I-746)+(3.015), (I-746)+(3.016), (I-746)+(3.017), (I-746)+(3.018), (I-746)+(3.019), (I-746)+(3.020), (I-746)+(3.021), (I-746)+(3.022), (I-746)+(3.023), (I-746)+(3.024), (I-746)+(3.025), (I-746)+(3.026), (I-746)+(3.027), (I-746)+(3.028), (I-746)+(3.029), (I-746)+(3.030), (I-746)+(3.031), (I-746)+(3.032), (I-746)+(4.001), (I-746)+(4.002), (I-746)+(4.003), (I-746)+(4.004), (I-746)+(4.005), (I-746)+(4.006), (I-746)+(4.007), (I-746)+(4.008), (I-746)+(4.009), (I-746)+(4.010), (I-746)+(4.011), (I-746)+(4.012), (I-746)+(4.013), (I-746)+(4.014), (I-746)+(4.015), (I-746)+(4.016), (I-746)+(4.017), (I-746)+(4.018), (I-746)+(4.019), (I-746)+(4.020), (I-746)+(4.021), (I-746)+(4.022), (I-746)+(4.023), (I-746)+(4.024), (I-746)+(4.025), (I-746)+(4.026), (I-746)+(5.001), (I-746)+(5.002), (I-746)+(5.003), (I-746)+(5.004), (I-746)+(5.005), (I-746)+(5.006), (I-746)+(5.007), (I-746)+(5.008), (I-746)+(5.009), (I-746)+(5.010), (I-746)+(5.011), (I-746)+(5.012), (I-746)+(5.013), (I-746)+(5.014), (I-746)+(5.015), (I-746)+(5.016), (I-746)+(5.017), (I-746)+(5.018), (I-746)+(5.019), (I-746)+(5.020), (I-746)+(5.021), (I-746)+(5.022), (I-746)+(5.023), (I-746)+(6.001), (I-746)+(6.002), (I-746)+(6.003), (I-746)+(6.004), (I-746)+(7.001), (I-746)+(7.002), (I-746)+(7.003), (I-746)+(7.004), (I-746)+(7.005), (I-746)+(7.006), (I-746)+(8.001), (I-746)+(9.001), (I-746)+(9.002), (I-746)+(9.003), (I-746)+(9.004), (I-746)+(9.005), (I-746)+(9.006), (I-746)+(9.007), (I-746)+(9.008), (I-746)+(9.009), (I-746)+(10.001), (I-746)+(10.002), (I-746)+(10.003), (I-746)+(11.001), (I-746)+(11.002), (I-746)+(12.001), (I-746)+(12.002), (I-746)+(12.003), (I-746)+(12.004), (I-746)+(13.001), (I-746)+(13.002), (I-746)+(13.003), (I-746)+(13.004), (I-746)+(13.005), (I-746)+(13.006), (I-746)+(14.001), (I-746)+(14.002), (I-746)+(15.001), (I-746)+(15.002), (I-746)+(15.003), (I-746)+(15.004), (I-746)+(15.005), (I-746)+(15.006), (I-746)+(15.007), (I-746)+(15.008), (I-746)+(15.009), (I-746)+(15.010), (I-746)+(15.011), (I-746)+(15.012), (I-746)+(15.013), (I-746)+(15.014), (I-746)+(15.015), (I-746)+(15.016), (I-746)+(15.017), (I-746)+(15.018), (I-746)+(15.019), (I-746)+(15.020), (I-746)+(15.021), (I-746)+(15.022), (I-746)+(15.023), (I-746)+(15.024), (I-746)+(15.025), (I-746)+(15.026), (I-746)+(15.027), (I-746)+(15.028), (I-746)+(15.029), (I-746)+(15.030), (I-746)+(15.031), (I-746)+(15.032), (I-746)+(15.033), (I-746)+(15.034), (I-746)+(15.035), (I-746)+(15.036), (I-746)+(15.037), (I-746)+(15.038), (I-746)+(15.039), (I-746)+(15.040), (I-746)+(15.041), (I-746)+(15.042), (I-746)+(15.043), (I-746)+(15.044), (I-746)+(15.045), (I-746)+(15.046), (I-746)+(15.047), (I-746)+(15.048), (I-746)+(15.049), (I-746)+(15.050), (I-746)+(15.051), (I-746)+(15.052), (I-746)+(15.053), (I-746)+(15.054), (I-746)+(15.055), (I-746)+(15.056), (I-746)+(15.057), (I-746)+(15.058), (I-746)+(15.059), (I-746)+(15.060), (I-746)+(15.061), (I-746)+(15.062), (I-746)+(15.063), (I-746)+(15.064), (I-746)+(15.065), (I-746)+(15.066), (I-746)+(15.067), (I-746)+(15.068), (I-746)+(15.069), (I-746)+(15.070), (I-746)+(15.071), (I-746)+(15.072), (I-746)+(15.073), (I-746)+(15.074), (I-746)+(15.075), (I-746)+(15.076), (I-746)+(15.077), (I-746)+(15.078), (I-746)+(15.079), (I-746)+(15.080), (I-746)+(15.081), (I-746)+(15.082), (I-746)+(15.083), (I-746)+(15.084), (I-746)+(15.085), (I-746)+(15.086), (I-746)+(15.087), (I-746)+(15.088), (I-746)+(15.089), (I-746)+(15.090), (I-746)+(15.091), (I-746)+(15.092), (I-746)+(15.093), (I-746)+(15.094), (I-746)+(15.095), (I-746)+(15.096), (I-746)+(15.097), (I-746)+(15.098), (I-746)+(15.099), (I-746)+(15.100), (I-746)+(15.101), (I-746)+(15.102), (I-746)+(15.103), (I-746)+(15.104), (I-746)+(15.105), (I-746)+(15.106), (I-746)+(15.107), (I-746)+(15.108), (I-746)+(15.109), (I-746)+(15.110), (I-746)+(15.111), (I-746)+(15.112), (I-746)+(15.113), (I-746)+(15.114), (I-746)+(15.115), (I-746)+(15.116), (I-746)+(15.117), (I-746)+(15.118), (I-746)+(15.119), (I-746)+(15.120), (I-746)+(15.121), (I-746)+(15.122), (I-746)+(15.123), (I-746)+(15.124), (I-746)+(15.125), (I-746)+(15.126), (I-746)+(15.127), (I-746)+(15.128), (I-746)+(16.001), (I-746)+(16.002), (I-746)+(16.003), (I-746)+(16.004), (I-746)+(16.005), (I-746)+(16.006), (I-746)+(16.007), (I-746)+(16.008), (I-746)+(17.001), (I-746)+(17.002), (I-746)+(17.003), (I-746)+(17.004), (I-746)+(17.005), (I-746)+(17.006), (I-746)+(17.007), (I-746)+(17.008), (I-746)+(17.009), (I-746)+(17.010), (I-746)+(17.011), (I-746)+(17.012) and (I-746)+(18.001).

Also preferred compound combinations are selected from group (G4) consisting of the following mixtures:

(I-749)+(1.001), (I-749)+(1.002), (I-749)+(1.003), (I-749)+(1.004), (I-749)+(1.005), (I-749)+(1.006), (I-749)+(1.007), (I-749)+(1.008), (I-749)+(1.009), (I-749)+(1.010), (I-749)+(1.011), (I-749)+(1.012), (I-749)+(1.013), (I-749)+(1.014), (I-749)+(1.015), (I-749)+(1.016), (I-749)+(1.017), (I-749)+(1.018), (I-749)+(1.019), (I-749)+(1.020), (I-749)+(1.021), (I-749)+(1.022), (I-749)+(1.023), (I-749)+(1.024), (I-749)+(1.025), (I-749)+(1.026), (I-749)+(1.027), (I-749)+(1.028), (I-749)+(1.029), (I-749)+(1.030), (I-749)+(1.031), (I-749)+(1.032), (I-749)+(1.033), (I-749)+(1.034), (I-749)+(1.035), (I-749)+(1.036), (I-749)+(1.037), (I-749)+(1.038), (I-749)+(1.039), (I-749)+(1.040), (I-749)+(1.041), (I-749)+(1.042), (I-749)+(1.043), (I-749)+(1.044), (I-749)+(1.045), (I-749)+(1.046), (I-749)+(1.047), (I-749)+(1.048), (I-749)+(1.049), (I-749)+(1.050), (I-749)+(1.051), (I-749)+(1.052), (I-749)+(1.053), (I-749)+(1.054), (I-749)+(1.055), (I-749)+(1.056), (I-749)+(1.057), (I-749)+(1.058), (I-749)+(1.059), (I-749)+(1.060), (I-749)+(1.061), (I-749)+(1.062), (I-749)+(1.063), (I-749)+(1.064), (I-749)+(1.065), (I-749)+(1.066), (I-749)+(1.067), (I-749)+(1.068), (I-749)+(1.069), (I-749)+(1.070), (I-749)+(1.071), (I-749)+(1.072), (I-749)+(1.073), (I-749)+(1.074), (I-749)+(1.075), (I-749)+(1.076), (I-749)+(1.077), (I-749)+(1.078), (I-749)+(1.079), (I-749)+(1.080), (I-749)+(1.081), (I-749)+(1.082), (I-749)+(1.083), (I-749)+(1.084), (I-749)+(1.085), (I-749)+(1.086), (I-749)+(1.087), (I-749)+(1.088), (I-749)+(1.089), (I-749)+(1.090), (I-749)+(1.091), (I-749)+(1.092), (I-749)+(2.001), (I-749)+(2.002), (I-749)+(2.003), (I-749)+(2.004), (I-749)+(2.005), (I-749)+(2.006), (I-749)+(2.007), (I-749)+(2.008), (I-749)+(2.009), (I-749)+(2.010), (I-749)+(2.011), (I-749)+(2.012), (I-749)+(2.013), (I-749)+(2.014), (I-749)+(2.015), (I-749)+(2.016), (I-749)+(2.017), (I-749)+(2.018), (I-749)+(2.019), (I-749)+(2.020), (I-749)+(2.021), (I-749)+(2.022), (I-749)+(2.023), (I-749)+(2.024), (I-749)+(2.025), (I-749)+(2.026), (I-749)+(2.027), (I-749)+(2.028), (I-749)+(2.029), (I-749)+(2.030), (I-749)+(2.031), (I-749)+(2.032), (I-749)+(2.033), (I-749)+(2.034), (I-749)+(2.035), (I-749)+(2.036), (I-749)+(2.037), (I-749)+(2.038), (I-749)+(2.039), (I-749)+(2.040), (I-749)+(2.041), (I-749)+(2.042), (I-749)+(2.043), (I-749)+(2.044), (I-749)+(2.045), (I-749)+(2.046), (I-749)+(2.047), (I-749)+(2.048), (I-749)+(2.049), (I-749)+(2.050), (I-749)+(2.051), (I-749)+(2.052), (I-749)+(2.053), (I-749)+(2.054), (I-749)+(2.055), (I-749)+(2.056), (I-749)+(2.057), (I-749)+(2.058), (I-749)+(2.059), (I-749)+(2.060), (I-749)+(3.001), (I-749)+(3.002), (I-749)+(3.003), (I-749)+(3.004), (I-749)+(3.005), (I-749)+(3.006), (I-749)+(3.007), (I-749)+(3.008), (I-749)+(3.009), (I-749)+(3.010), (I-749)+(3.011), (I-749)+(3.012), (I-749)+(3.013), (I-749)+(3.014), (I-749)+(3.015), (I-749)+(3.016), (I-749)+(3.017), (I-749)+(3.018), (I-749)+(3.019), (I-749)+(3.020), (I-749)+(3.021), (I-749)+(3.022), (I-749)+(3.023), (I-749)+(3.024), (I-749)+(3.025), (I-749)+(3.026), (I-749)+(3.027), (I-749)+(3.028), (I-749)+(3.029), (I-749)+(3.030), (I-749)+(3.030), (I-749)+(3.031), (I-749)+(4.001), (I-749)+(4.002), (I-749)+(4.003), (I-749)+(4.004), (I-749)+(4.005), (I-749)+(4.006), (I-749)+(4.007), (I-749)+(4.008), (I-749)+(4.009), (I-749)+(4.010), (I-749)+(4.011), (I-749)+(4.012), (I-749)+(4.013), (I-749)+(4.014), (I-749)+(4.015), (I-749)+(4.016), (I-749)+(4.017), (I-749)+(4.018), (I-749)+(4.019), (I-749)+(4.020), (I-749)+(4.021), (I-749)+(4.022), (I-749)+(4.023), (I-749)+(4.024), (I-749)+(4.025), (I-749)+(4.026), (I-749)+(5.001), (I-749)+(5.002), (I-749)+(5.003), (I-749)+(5.004), (I-749)+(5.005), (I-749)+(5.006), (I-749)+(5.007), (I-749)+(5.008), (I-749)+(5.009), (I-749)+(5.010), (I-749)+(5.011), (I-749)+(5.012), (I-749)+(5.013), (I-749)+(5.014), (I-749)+(5.015), (I-749)+(5.016), (I-749)+(5.017), (I-749)+(5.018), (I-749)+(5.019), (I-749)+(5.020), (I-749)+(5.021), (I-749)+(5.022), (I-749)+(5.023), (I-749)+(6.001), (I-749)+(6.002), (I-749)+(6.003), (I-749)+(6.004), (I-749)+(7.001), (I-749)+(7.002), (I-749)+(7.003), (I-749)+(7.004), (I-749)+(7.005), (I-749)+(7.006), (I-749)+(8.001), (I-749)+(9.001), (I-749)+(9.002), (I-749)+(9.003), (I-749)+(9.004), (I-749)+(9.005), (I-749)+(9.006), (I-749)+(9.007), (I-749)+(9.008), (I-749)+(9.009), (I-749)+(10.001), (I-749)+(10.002), (I-749)+(10.003), (I-749)+(11.001), (I-749)+(11.002), (I-749)+(12.001), (I-749)+(12.002), (I-749)+(12.003), (I-749)+(12.004), (I-749)+(13.001), (I-749)+(13.002), (I-749)+(13.003), (I-749)+(13.004), (I-749)+(13.005), (I-749)+(13.006), (I-749)+(14.001), (I-749)+(14.002), (I-749)+(15.001), (I-749)+(15.002), (I-749)+(15.003), (I-749)+(15.004), (I-749)+(15.005), (I-749)+(15.006), (I-749)+(15.007), (I-749)+(15.008), (I-749)+(15.009), (I-749)+(15.010), (I-749)+(15.011), (I-749)+(15.012), (I-749)+(15.013), (I-749)+(15.014), (I-749)+(15.015), (I-749)+(15.016), (I-749)+(15.017), (I-749)+(15.018), (I-749)+(15.019), (I-749)+(15.020), (I-749)+(15.021), (I-749)+(15.022), (I-749)+(15.023), (I-749)+(15.024), (I-749)+(15.025), (I-749)+(15.026), (I-749)+(15.027), (I-749)+(15.028), (I-749)+(15.029), (I-749)+(15.030), (I-749)+(15.031), (I-749)+(15.032), (I-749)+(15.033), (I-749)+(15.034), (I-749)+(15.035), (I-749)+(15.036), (I-749)+(15.037), (I-749)+(15.038), (I-749)+(15.039), (I-749)+(15.040), (I-749)+(15.041), (I-749)+(15.042), (I-749)+(15.043), (I-749)+(15.044), (I-749)+(15.045), (I-749)+(15.046), (I-749)+(15.047), (I-749)+(15.048), (I-749)+(15.049), (I-749)+(15.050), (I-749)+(15.051), (I-749)+(15.052), (I-749)+(15.053), (I-749)+(15.054), (I-749)+(15.055), (I-749)+(15.056), (I-749)+(15.057), (I-749)+(15.058), (I-749)+(15.059), (I-749)+(15.060), (I-749)+(15.061), (I-749)+(15.062), (I-749)+(15.063), (I-749)+(15.064), (I-749)+(15.065), (I-749)+(15.066), (I-749)+(15.067), (I-749)+(15.068), (I-749)+(15.069), (I-749)+(15.070), (I-749)+(15.071), (I-749)+(15.072), (I-749)+(15.073), (I-749)+(15.074), (I-749)+(15.075), (I-749)+(15.076), (I-749)+(15.077), (I-749)+(15.078), (I-749)+(15.079), (I-749)+(15.080), (I-749)+(15.081), (I-749)+(15.082), (I-749)+(15.083), (I-749)+(15.084), (I-749)+(15.085), (I-749)+(15.086), (I-749)+(15.087), (I-749)+(15.088), (I-749)+(15.089), (I-749)+(15.090), (I-749)+(15.091), (I-749)+(15.092), (I-749)+(15.093), (I-749)+(15.094), (I-749)+(15.095), (I-749)+(15.096), (I-749)+(15.097), (I-749)+(15.098), (I-749)+(15.099), (I-749)+(15.100), (I-749)+(15.101), (I-749)+(15.102), (I-749)+(15.103), (I-749)+(15.104), (I-749)+(15.105), (I-749)+(15.106), (I-749)+(15.107), (I-749)+(15.108), (I-749)+(15.109), (I-749)+(15.110), (I-749)+(15.111), (I-749)+(15.112), (I-749)+(15.113), (I-749)+(15.114), (I-749)+(15.115), (I-749)+(15.116), (I-749)+(15.117), (I-749)+(15.118), (I-749)+(15.119), (I-749)+(15.120), (I-749)+(15.121), (I-749)+(15.122), (I-749)+(15.123), (I-749)+(15.124), (I-749)+(15.125), (I-749)+(15.126), (I-749)+(15.127), (I-749)+(15.128), (I-749)+(16.1001), (I-749)+(16.1002), (I-749)+(16.1003), (I-749)+(16.1004), (I-749)+(16.1005), (I-749)+(16.2001), (I-749)+(16.2002), (I-749)+(16.2003), (I-749)+(17.001), (I-749)+(17.002), (I-749)+(17.003), (I-749)+(17.004), (I-749)+(17.005), (I-749)+(17.006), (I-749)+(17.007), (I-749)+(17.008), (I-749)+(17.009), (I-749)+(17.010), (I-749)+(17.011), (I-749)+(17.012) and (I-749)+(18.001).

Also preferred compound combinations are selected from group (G5) consisting of the following mixtures:

(I-784)+(1.001), (I-784)+(1.002), (I-784)+(1.003), (I-784)+(1.004), (I-784)+(1.005), (I-784)+(1.006), (I-784)+(1.007), (I-784)+(1.008), (I-784)+(1.009), (I-784)+(1.010), (I-784)+(1.011), (I-784)+(1.012), (I-784)+(1.013), (I-784)+(1.014), (I-784)+(1.015), (I-784)+(1.016), (I-784)+(1.017), (I-784)+(1.018), (I-784)+(1.019), (I-784)+(1.020), (I-784)+(1.021), (I-784)+(1.022), (I-784)+(1.023), (I-784)+(1.024), (I-784)+(1.025), (I-784)+(1.026), (I-784)+(1.027), (I-784)+(1.028), (I-784)+(1.029), (I-784)+(1.030), (I-784)+(1.031), (I-784)+(1.032), (I-784)+(1.033), (I-784)+(1.034), (I-784)+(1.035), (I-784)+(1.036), (I-784)+(1.037), (I-784)+(1.038), (I-784)+(1.039), (I-784)+(1.040), (I-784)+(1.041), (I-784)+(1.042), (I-784)+(1.043), (I-784)+(1.044), (I-784)+(1.045), (I-784)+(1.046), (I-784)+(1.047), (I-784)+(1.048), (I-784)+(1.049), (I-784)+(1.050), (I-784)+(1.051), (I-784)+(1.052), (I-784)+(1.053), (I-784)+(1.054), (I-784)+(1.055), (I-784)+(1.056), (I-784)+(1.057), (I-784)+(1.058), (I-784)+(1.059), (I-784)+(1.060), (I-784)+(1.061), (I-784)+(1.062), (I-784)+(1.063), (I-784)+(1.064), (I-784)+(1.065), (I-784)+(1.066), (I-784)+(1.067), (I-784)+(1.068), (I-784)+(1.069), (I-784)+(1.070), (I-784)+(1.071), (I-784)+(1.072), (I-784)+(1.073), (I-784)+(1.074), (I-784)+(1.075), (I-784)+(1.076), (I-784)+(1.077), (I-784)+(1.078), (I-784)+(1.079), (I-784)+(1.080), (I-784)+(1.081), (I-784)+(1.082), (I-784)+(1.083), (I-784)+(1.084), (I-784)+(1.085), (I-784)+(1.086), (I-784)+(1.087), (I-784)+(1.088), (I-784)+(1.089), (I-784)+(1.090), (I-784)+(1.091), (I-784)+(1.092), (I-784)+(2.001), (I-784)+(2.002), (I-784)+(2.003), (I-784)+(2.004), (I-784)+(2.005), (I-784)+(2.006), (I-784)+(2.007), (I-784)+(2.008), (I-784)+(2.009), (I-784)+(2.010), (I-784)+(2.011), (I-784)+(2.012), (I-784)+(2.013), (I-784)+(2.014), (I-784)+(2.015), (I-784)+(2.016), (I-784)+(2.017), (I-784)+(2.018), (I-784)+(2.019), (I-784)+(2.020), (I-784)+(2.021), (I-784)+(2.022), (I-784)+(2.023), (I-784)+(2.024), (I-784)+(2.025), (I-784)+(2.026), (I-784)+(2.027), (I-784)+(2.028), (I-784)+(2.029), (I-784)+(2.030), (I-784)+(2.031), (I-784)+(2.032), (I-784)+(2.033), (I-784)+(2.034), (I-784)+(2.035), (I-784)+(2.036), (I-784)+(2.037), (I-784)+(2.038), (I-784)+(2.039), (I-784)+(2.040), (I-784)+(2.041), (I-784)+(2.042), (I-784)+(2.043), (I-784)+(2.044), (I-784)+(2.045), (I-784)+(2.046), (I-784)+(2.047), (I-784)+(2.048), (I-784)+(2.049), (I-784)+(2.050), (I-784)+(2.051), (I-784)+(2.052), (I-784)+(2.053), (I-784)+(2.054), (I-784)+(2.055), (I-784)+(2.056), (I-784)+(2.057), (I-784)+(2.058), (I-784)+(2.059), (I-784)+(2.060), (I-784)+(3.001), (I-784)+(3.002), (I-784)+(3.003), (I-784)+(3.004), (I-784)+(3.005), (I-784)+(3.006), (I-784)+(3.007), (I-784)+(3.008), (I-784)+(3.009), (I-784)+(3.010), (I-784)+(3.011), (I-784)+(3.012), (I-784)+(3.013), (I-784)+(3.014), (I-784)+(3.015), (I-784)+(3.016), (I-784)+(3.017), (I-784)+(3.018), (I-784)+(3.019), (I-784)+(3.020), (I-784)+(3.021), (I-784)+(3.022), (I-784)+(3.023), (I-784)+(3.024), (I-784)+(3.025), (I-784)+(3.026), (I-784)+(3.027), (I-784)+(3.028), (I-784)+(3.029), (I-784)+(3.030), (I-784)+(3.031), (I-784)+(3.032), (I-784)+(4.001), (I-784)+(4.002), (I-784)+(4.003), (I-784)+(4.004), (I-784)+(4.005), (I-784)+(4.006), (I-784)+(4.007), (I-784)+(4.008), (I-784)+(4.009), (I-784)+(4.010), (I-784)+(4.011), (I-784)+(4.012), (I-784)+(4.013), (I-784)+(4.014), (I-784)+(4.015), (I-784)+(4.016), (I-784)+(4.017), (I-784)+(4.018), (I-784)+(4.019), (I-784)+(4.020), (I-784)+(4.021), (I-784)+(4.022), (I-784)+(4.023), (I-784)+(4.024), (I-784)+(4.025), (I-784)+(4.026), (I-784)+(5.001), (I-784)+(5.002), (I-784)+(5.003), (I-784)+(5.004), (I-784)+(5.005), (I-784)+(5.006), (I-784)+(5.007), (I-784)+(5.008), (I-784)+(5.009), (I-784)+(5.010), (I-784)+(5.011), (I-784)+(5.012), (I-784)+(5.013), (I-784)+(5.014), (I-784)+(5.015), (I-784)+(5.016), (I-784)+(5.017), (I-784)+(5.018), (I-784)+(5.019), (I-784)+(5.020), (I-784)+(5.021), (I-784)+(5.022), (I-784)+(5.023), (I-784)+(6.001), (I-784)+(6.002), (I-784)+(6.003), (I-784)+(6.004), (I-784)+(7.001), (I-784)+(7.002), (I-784)+(7.003), (I-784)+(7.004), (I-784)+(7.005), (I-784)+(7.006), (I-784)+(8.001), (I-784)+(9.001), (I-784)+(9.002), (I-784)+(9.003), (I-784)+(9.004), (I-784)+(9.005), (I-784)+(9.006), (I-784)+(9.007), (I-784)+(9.008), (I-784)+(9.009), (I-784)+(10.001), (I-784)+(10.002), (I-784)+(10.003), (I-784)+(11.001), (I-784)+(11.002), (I-784)+(12.001), (I-784)+(12.002), (I-784)+(12.003), (I-784)+(12.004), (I-784)+(13.001), (I-784)+(13.002), (I-784)+(13.003), (I-784)+(13.004), (I-784)+(13.005), (I-784)+(13.006), (I-784)+(14.001), (I-784)+(14.002), (I-784)+(15.001), (I-784)+(15.002), (I-784)+(15.003), (I-784)+(15.004), (I-784)+(15.005), (I-784)+(15.006), (I-784)+(15.007), (I-784)+(15.008), (I-784)+(15.009), (I-784)+(15.010), (I-784)+(15.011), (I-784)+(15.012), (I-784)+(15.013), (I-784)+(15.014), (I-784)+(15.015), (I-784)+(15.016), (I-784)+(15.017), (I-784)+(15.018), (I-784)+(15.019), (I-784)+(15.020), (I-784)+(15.021), (I-784)+(15.022), (I-784)+(15.023), (I-784)+(15.024), (I-784)+(15.025), (I-784)+(15.026), (I-784)+(15.027), (I-784)+(15.028), (I-784)+(15.029), (I-784)+(15.030), (I-784)+(15.031), (I-784)+(15.032), (I-784)+(15.033), (I-784)+(15.034), (I-784)+(15.035), (I-784)+(15.036), (I-784)+(15.037), (I-784)+(15.038), (I-784)+(15.039), (I-784)+(15.040), (I-784)+(15.041), (I-784)+(15.042), (I-784)+(15.043), (I-784)+(15.044), (I-784)+(15.045), (I-784)+(15.046), (I-784)+(15.047), (I-784)+(15.048), (I-784)+(15.049), (I-784)+(15.050), (I-784)+(15.051), (I-784)+(15.052), (I-784)+(15.053), (I-784)+(15.054), (I-784)+(15.055), (I-784)+(15.056), (I-784)+(15.057), (I-784)+(15.058), (I-784)+(15.059), (I-784)+(15.060), (I-784)+(15.061), (I-784)+(15.062), (I-784)+(15.063), (I-784)+(15.064), (I-784)+(15.065), (I-784)+(15.066), (I-784)+(15.067), (I-784)+(15.068), (I-784)+(15.069), (I-784)+(15.070), (I-784)+(15.071), (I-784)+(15.072), (I-784)+(15.073), (I-784)+(15.074), (I-784)+(15.075), (I-784)+(15.076), (I-784)+(15.077), (I-784)+(15.078), (I-784)+(15.079), (I-784)+(15.080), (I-784)+(15.081), (I-784)+(15.082), (I-784)+(15.083), (I-784)+(15.084), (I-784)+(15.085), (I-784)+(15.086), (I-784)+(15.087), (I-784)+(15.088), (I-784)+(15.089), (I-784)+(15.090), (I-784)+(15.091), (I-784)+(15.092), (I-784)+(15.093), (I-784)+(15.094), (I-784)+(15.095), (I-784)+(15.096), (I-784)+(15.097), (I-784)+(15.098), (I-784)+(15.099), (I-784)+(15.100), (I-784)+(15.101), (I-784)+(15.102), (I-784)+(15.103), (I-784)+(15.104), (I-784)+(15.105), (I-784)+(15.106), (I-784)+(15.107), (I-784)+(15.108), (I-784)+(15.109), (I-784)+(15.110), (I-784)+(15.111), (I-784)+(15.112), (I-784)+(15.113), (I-784)+(15.114), (I-784)+(15.115), (I-784)+(15.116), (I-784)+(15.117), (I-784)+(15.118), (I-784)+(15.119), (I-784)+(15.120), (I-784)+(15.121), (I-784)+(15.122), (I-784)+(15.123), (I-784)+(15.124), (I-784)+(15.125), (I-784)+(15.126), (I-784)+(15.127), (I-784)+(15.128), (I-784)+(16.001), (I-784)+(16.002), (I-784)+(16.003), (I-784)+(16.004), (I-784)+(16.005), (I-784)+(16.006), (I-784)+(16.007), (I-784)+(16.008), (I-784)+(17.001), (I-784)+(17.002), (I-784)+(17.003), (I-784)+(17.004), (I-784)+(17.005), (I-784)+(17.006), (I-784)+(17.007), (I-784)+(17.008), (I-784)+(17.009), (I-784)+(17.010), (I-784)+(17.011), (I-784)+(17.012) and (I-784)+(18.001).

Also preferred compound combinations are selected from group (G6) consisting of the following mixtures:

(I-840)+(1.001), (I-840)+(1.002), (I-840)+(1.003), (I-840)+(1.004), (I-840)+(1.005), (I-840)+(1.006), (I-840)+(1.007), (I-840)+(1.008), (I-840)+(1.009), (I-840)+(1.010), (I-840)+(1.011), (I-840)+(1.012), (I-840)+(1.013), (I-840)+(1.014), (I-840)+(1.015), (I-840)+(1.016), (I-840)+(1.017), (I-840)+(1.018), (I-840)+(1.019), (I-840)+(1.020), (I-840)+(1.021), (I-840)+(1.022), (I-840)+(1.023), (I-840)+(1.024), (I-840)+(1.025), (I-840)+(1.026), (I-840)+(1.027), (I-840)+(1.028), (I-840)+(1.029), (I-840)+(1.030), (I-840)+(1.031), (I-840)+(1.032), (I-840)+(1.033), (I-840)+(1.034), (I-840)+(1.035), (I-840)+(1.036), (I-840)+(1.037), (I-840)+(1.038), (I-840)+(1.039), (I-840)+(1.040), (I-840)+(1.041), (I-840)+(1.042), (I-840)+(1.043), (I-840)+(1.044), (I-840)+(1.045), (I-840)+(1.046), (I-840)+(1.047), (I-840)+(1.048), (I-840)+(1.049), (I-840)+(1.050), (I-840)+(1.051), (I-840)+(1.052), (I-840)+(1.053), (I-840)+(1.054), (I-840)+(1.055), (I-840)+(1.056), (I-840)+(1.057), (I-840)+(1.058), (I-840)+(1.059), (I-840)+(1.060), (I-840)+(1.061), (I-840)+(1.062), (I-840)+(1.063), (I-840)+(1.064), (I-840)+(1.065), (I-840)+(1.066), (I-840)+(1.067), (I-840)+(1.068), (I-840)+(1.069), (I-840)+(1.070), (I-840)+(1.071), (I-840)+(1.072), (I-840)+(1.073), (I-840)+(1.074), (I-840)+(1.075), (I-840)+(1.076), (I-840)+(1.077), (I-840)+(1.078), (I-840)+(1.079), (I-840)+(1.080), (I-840)+(1.081), (I-840)+(1.082), (I-840)+(1.083), (I-840)+(1.084), (I-840)+(1.085), (I-840)+(1.086), (I-840)+(1.087), (I-840)+(1.088), (I-840)+(1.089), (I-840)+(1.090), (I-840)+(1.091), (I-840)+(1.092), (I-840)+(2.001), (I-840)+(2.002), (I-840)+(2.003), (I-840)+(2.004), (I-840)+(2.005), (I-840)+(2.006), (I-840)+(2.007), (I-840)+(2.008), (I-840)+(2.009), (I-840)+(2.010), (I-840)+(2.011), (I-840)+(2.012), (I-840)+(2.013), (I-840)+(2.014), (I-840)+(2.015), (I-840)+(2.016), (I-840)+(2.017), (I-840)+(2.018), (I-840)+(2.019), (I-840)+(2.020), (I-840)+(2.021), (I-840)+(2.022), (I-840)+(2.023), (I-840)+(2.024), (I-840)+(2.025), (I-840)+(2.026), (I-840)+(2.027), (I-840)+(2.028), (I-840)+(2.029), (I-840)+(2.030), (I-840)+(2.031), (I-840)+(2.032), (I-840)+(2.033), (I-840)+(2.034), (I-840)+(2.035), (I-840)+(2.036), (I-840)+(2.037), (I-840)+(2.038), (I-840)+(2.039), (I-840)+(2.040), (I-840)+(2.041), (I-840)+(2.042), (I-840)+(2.043), (I-840)+(2.044), (I-840)+(2.045), (I-840)+(2.046), (I-840)+(2.047), (I-840)+(2.048), (I-840)+(2.049), (I-840)+(2.050), (I-840)+(2.051), (I-840)+(2.052), (I-840)+(2.053), (I-840)+(2.054), (I-840)+(2.055), (I-840)+(2.056), (I-840)+(2.057), (I-840)+(2.058), (I-840)+(2.059), (I-840)+(2.060), (I-840)+(3.001), (I-840)+(3.002), (I-840)+(3.003), (I-840)+(3.004), (I-840)+(3.005), (I-840)+(3.006), (I-840)+(3.007), (I-840)+(3.008), (I-840)+(3.009), (I-840)+(3.010), (I-840)+(3.011), (I-840)+(3.012), (I-840)+(3.013), (I-840)+(3.014), (I-840)+(3.015), (I-840)+(3.016), (I-840)+(3.017), (I-840)+(3.018), (I-840)+(3.019), (I-840)+(3.020), (I-840)+(3.021), (I-840)+(3.022), (I-840)+(3.023), (I-840)+(3.024), (I-840)+(3.025), (I-840)+(3.026), (I-840)+(3.027), (I-840)+(3.028), (I-840)+(3.029), (I-840)+(3.030), (I-840)+(3.031), (I-840)+(3.032), (I-840)+(4.001), (I-840)+(4.002), (I-840)+(4.003), (I-840)+(4.004), (I-840)+(4.005), (I-840)+(4.006), (I-840)+(4.007), (I-840)+(4.008), (I-840)+(4.009), (I-840)+(4.010), (I-840)+(4.011), (I-840)+(4.012), (I-840)+(4.013), (I-840)+(4.014), (I-840)+(4.015), (I-840)+(4.016), (I-840)+(4.017), (I-840)+(4.018), (I-840)+(4.019), (I-840)+(4.020), (I-840)+(4.021), (I-840)+(4.022), (I-840)+(4.023), (I-840)+(4.024), (I-840)+(4.025), (I-840)+(4.026), (I-840)+(5.001), (I-840)+(5.002), (I-840)+(5.003), (I-840)+(5.004), (I-840)+(5.005), (I-840)+(5.006), (I-840)+(5.007), (I-840)+(5.008), (I-840)+(5.009), (I-840)+(5.010), (I-840)+(5.011), (I-840)+(5.012), (I-840)+(5.013), (I-840)+(5.014), (I-840)+(5.015), (I-840)+(5.016), (I-840)+(5.017), (I-840)+(5.018), (I-840)+(5.019), (I-840)+(5.020), (I-840)+(5.021), (I-840)+(5.022), (I-840)+(5.023), (I-840)+(6.001), (I-840)+(6.002), (I-840)+(6.003), (I-840)+(6.004), (I-840)+(7.001), (I-840)+(7.002), (I-840)+(7.003), (I-840)+(7.004), (I-840)+(7.005), (I-840)+(7.006), (I-840)+(8.001), (I-840)+(9.001), (I-840)+(9.002), (I-840)+(9.003), (I-840)+(9.004), (I-840)+(9.005), (I-840)+(9.006), (I-840)+(9.007), (I-840)+(9.008), (I-840)+(9.009), (I-840)+(10.001), (I-840)+(10.002), (I-840)+(10.003), (I-840)+(11.001), (I-840)+(11.002), (I-840)+(12.001), (I-840)+(12.002), (I-840)+(12.003), (I-840)+(12.004), (I-840)+(13.001), (I-840)+(13.002), (I-840)+(13.003), (I-840)+(13.004), (I-840)+(13.005), (I-840)+(13.006), (I-840)+(14.001), (I-840)+(14.002), (I-840)+(15.001), (I-840)+(15.002), (I-840)+(15.003), (I-840)+(15.004), (I-840)+(15.005), (I-840)+(15.006), (I-840)+(15.007), (I-840)+(15.008), (I-840)+(15.009), (I-840)+(15.010), (I-840)+(15.011), (I-840)+(15.012), (I-840)+(15.013), (I-840)+(15.014), (I-840)+(15.015), (I-840)+(15.016), (I-840)+(15.017), (I-840)+(15.018), (I-840)+(15.019), (I-840)+(15.020), (I-840)+(15.021), (I-840)+(15.022), (I-840)+(15.023), (I-840)+(15.024), (I-840)+(15.025), (I-840)+(15.026), (I-840)+(15.027), (I-840)+(15.028), (I-840)+(15.029), (I-840)+(15.030), (I-840)+(15.031), (I-840)+(15.032), (I-840)+(15.033), (I-840)+(15.034), (I-840)+(15.035), (I-840)+(15.036), (I-840)+(15.037), (I-840)+(15.038), (I-840)+(15.039), (I-840)+(15.040), (I-840)+(15.041), (I-840)+(15.042), (I-840)+(15.043), (I-840)+(15.044), (I-840)+(15.045), (I-840)+(15.046), (I-840)+(15.047), (I-840)+(15.048), (I-840)+(15.049), (I-840)+(15.050), (I-840)+(15.051), (I-840)+(15.052), (I-840)+(15.053), (I-840)+(15.054), (I-840)+(15.055), (I-840)+(15.056), (I-840)+(15.057), (I-840)+(15.058), (I-840)+(15.059), (I-840)+(15.060), (I-840)+(15.061), (I-840)+(15.062), (I-840)+(15.063), (I-840)+(15.064), (I-840)+(15.065), (I-840)+(15.066), (I-840)+(15.067), (I-840)+(15.068), (I-840)+(15.069), (I-840)+(15.070), (I-840)+(15.071), (I-840)+(15.072), (I-840)+(15.073), (I-840)+(15.074), (I-840)+(15.075), (I-840)+(15.076), (I-840)+(15.077), (I-840)+(15.078), (I-840)+(15.079), (I-840)+(15.080), (I-840)+(15.081), (I-840)+(15.082), (I-840)+(15.083), (I-840)+(15.084), (I-840)+(15.085), (I-840)+(15.086), (I-840)+(15.087), (I-840)+(15.088), (I-840)+(15.089), (I-840)+(15.090), (I-840)+(15.091), (I-840)+(15.092), (I-840)+(15.093), (I-840)+(15.094), (I-840)+(15.095), (I-840)+(15.096), (I-840)+(15.097), (I-840)+(15.098), (I-840)+(15.099), (I-840)+(15.100), (I-840)+(15.101), (I-840)+(15.102), (I-840)+(15.103), (I-840)+(15.104), (I-840)+(15.105), (I-840)+(15.106), (I-840)+(15.107), (I-840)+(15.108), (I-840)+(15.109), (I-840)+(15.110), (I-840)+(15.111), (I-840)+(15.112), (I-840)+(15.113), (I-840)+(15.114), (I-840)+(15.115), (I-840)+(15.116), (I-840)+(15.117), (I-840)+(15.118), (I-840)+(15.119), (I-840)+(15.120), (I-840)+(15.121), (I-840)+(15.122), (I-840)+(15.123), (I-840)+(15.124), (I-840)+(15.125), (I-840)+(15.126), (I-840)+(15.127), (I-840)+(15.128), (I-840)+(16.001), (I-840)+(16.002), (I-840)+(16.003), (I-840)+(16.004), (I-840)+(16.005), (I-840)+(16.006), (I-840)+(16.007), (I-840)+(16.008), (I-840)+(17.001), (I-840)+(17.002), (I-840)+(17.003), (I-840)+(17.004), (I-840)+(17.005), (I-840)+(17.006), (I-840)+(17.007), (I-840)+(17.008), (I-840)+(17.009), (I-840)+(17.010), (I-840)+(17.011), (I-840)+(17.012) and (I-840)+(18.001).

More preferred the compound combinations are selected from the mixtures belonging to groups (G1), (G3) and (G4).

Even more preferred compound combinations are selected from the group (G1-A) consisting of the following mixtures:

(I-655)+(1.002), (I-655)+(1.004), (I-655)+(1.010), (I-655)+(1.012), (I-655)+(1.018), (I-655)+(1.020), (I-655)+(1.021), (I-655)+(1.026), (I-655)+(1.027), (I-655)+(1.055), (I-655)+(1.059), (I-655)+(1.081), (I-655)+(1.082), (I-655)+(1.092), (I-655)+(2.001), (I-655)+(2.002), (I-655)+(2.003), (I-655)+(2.005), (I-655)+(2.007), (I-655)+(2.017), (I-655)+(2.018), (I-655)+(2.019), (I-655)+(2.021), (I-655)+(2.028), (I-655)+(2.030), (I-655)+(2.038), (I-655)+(3.003), (I-655)+(3.012), (I-655)+(3.016), (I-655)+(3.017), (I-655)+(3.020), (I-655)+(3.025), (I-655)+(3.026), (I-655)+(3.030), (I-655)+(3.031), (I-655)+(4.005), (I-655)+(4.007), (I-655)+(4.012), (I-655)+(4.015), (I-655)+(4.025), (I-655)+(5.003), (I-655)+(5.004), (I-655)+(5.010), (I-655)+(5.012), (I-655)+(5.013), (I-655)+(5.015), (I-655)+(5.018), (I-655)+(6.002), (I-655)+(7.005), (I-655)+(9.004), (I-655)+(12.003), (I-655)+(12.004), (I-655)+(13.001), (I-655)+(13.004), (I-655)+(13.005), (I-655)+(14.001), (I-655)+(14.002), (I-655)+(15.008), (I-655)+(15.012), (I-655)+(15.016), (I-655)+(15.027), (I-655)+(15.047), (I-655)+(15.048), (I-655)+(15.052), (I-655)+(15.062), (I-655)+(15.064), (I-655)+(16.001), (I-655)+(17.001), (I-655)+(17.012) and (I-655)+(18.001).

Even more preferred compound combinations are also selected from the group (G3-A) consisting of the following mixtures:

(I-746)+(1.002), (I-746)+(1.004), (I-746)+(1.010), (I-746)+(1.012), (I-746)+(1.018), (I-746)+(1.020), (I-746)+(1.021), (I-746)+(1.026), (I-746)+(1.027), (I-746)+(1.055), (I-746)+(1.059), (I-746)+(1.081), (I-746)+(1.082), (I-746)+(1.092), (I-746)+(2.001), (I-746)+(2.002), (I-746)+(2.003), (I-746)+(2.005), (I-746)+(2.007), (I-746)+(2.017), (I-746)+(2.018), (I-746)+(2.019), (I-746)+(2.021), (I-746)+(2.028), (I-746)+(2.030), (I-746)+(2.038), (I-746)+(3.003), (I-746)+(3.012), (I-746)+(3.016), (I-746)+(3.017), (I-746)+(3.020), (I-746)+(3.025), (I-746)+(3.026), (I-746)+(3.030), (I-746)+(3.031), (I-746)+(4.005), (I-746)+(4.007), (I-746)+(4.012), (I-746)+(4.015), (I-746)+(4.025), (I-746)+(5.003), (I-746)+(5.004), (I-746)+(5.010), (I-746)+(5.012), (I-746)+(5.013), (I-746)+(5.015), (I-746)+(5.018), (I-746)+(6.002), (I-746)+(7.005), (I-746)+(9.004), (I-746)+(12.003), (I-746)+(12.004), (I-746)+(13.001), (I-746)+(13.004), (I-746)+(13.005), (I-746)+(14.001), (I-746)+(14.002), (I-746)+(15.008), (I-746)+(15.012), (I-746)+(15.016), (I-746)+(15.027), (I-746)+(15.047), (I-746)+(15.048), (I-746)+(15.052), (I-746)+(15.062), (I-746)+(15.064), (I-746)+(16.001), (I-746)+(17.001), (I-746)+(17.012) and (I-746)+(18.001).

Even more preferred compound combinations are also selected from the group (G4-A) consisting of the following mixtures:

(I-749)+(1.002), (I-749)+(1.004), (I-749)+(1.010), (I-749)+(1.012), (I-749)+(1.018), (I-749)+(1.020), (I-749)+(1.021), (I-749)+(1.026), (I-749)+(1.027), (I-749)+(1.055), (I-749)+(1.059), (I-749)+(1.081), (I-749)+(1.082), (I-749)+(1.092), (I-749)+(2.001), (I-749)+(2.002), (I-749)+(2.003), (I-749)+(2.005), (I-749)+(2.007), (I-749)+(2.017), (I-749)+(2.018), (I-749)+(2.019), (I-749)+(2.021), (I-749)+(2.028), (I-749)+(2.030), (I-749)+(2.038), (I-749)+(3.003), (I-749)+(3.012), (I-749)+(3.016), (I-749)+(3.017), (I-749)+(3.020), (I-749)+(3.025), (I-749)+(3.026), (I-749)+(3.030), (I-749)+(3.031), (I-749)+(4.005), (I-749)+(4.007), (I-749)+(4.012), (I-749)+(4.015), (I-749)+(4.025), (I-749)+(5.003), (I-749)+(5.004), (I-749)+(5.010), (I-749)+(5.012), (I-749)+(5.013), (I-749)+(5.015), (I-749)+(5.018), (I-749)+(6.002), (I-749)+(7.005), (I-749)+(9.004), (I-749)+(12.003), (I-749)+(12.004), (I-749)+(13.001), (I-749)+(13.004), (I-749)+(13.005), (I-749)+(14.001), (I-749)+(14.002), (I-749)+(15.008), (I-749)+(15.012), (I-749)+(15.016), (I-749)+(15.027), (I-749)+(15.047), (I-749)+(15.048), (I-749)+(15.052), (I-749)+(15.062), (I-749)+(15.064), (I-749)+(16.001), (I-749)+(17.001), (I-749)+(17.012) and (I-749)+(18.001).

Still even more preferred compound combinations are selected from the group (G1-A) consisting of the following mixtures:

(I-655)+(1.002), (I-655)+(1.018), (I-655)+(1.020), (I-655)+(1.021), (I-655)+(1.055), (I-655)+(2.002), (I-655)+(2.005), (I-655)+(2.028), (I-655)+(2.038), (I-655)+(3.020), (I-655)+(3.025), (I-655)+(5.003), (I-655)+(5.010), (I-655)+(5.012), (I-655)+(5.013), (I-655)+(5.018), (I-655)+(6.002), (I-655)+(7.005), (I-655)+(13.001), (I-655)+(13.004), (I-655)+(13.005), (I-655)+(15.012), (I-655)+(15.016), (I-655)+(15.064) and (I-655)+(18.001).

Still even more preferred compound combinations are also selected from the group (G3-A) consisting of the following mixtures:

(I-746)+(1.002), (I-746)+(1.018), (I-746)+(1.020), (I-746)+(1.021), (I-746)+(1.055), (I-746)+(2.002), (I-746)+(2.005), (I-746)+(2.028), (I-746)+(2.038), (I-746)+(3.020), (I-746)+(3.025), (I-746)+(5.003), (I-746)+(5.010), (I-746)+(5.012), (I-746)+(5.013), (I-746)+(5.018), (I-746)+(6.002), (I-746)+(7.005), (I-746)+(13.001), (I-746)+(13.004), (I-746)+(13.005), (I-746)+(15.012), (I-746)+(15.016), (I-746)+(15.064) and (I-746)+(18.001).

Still even more preferred compound combinations are also selected from the group (G4-A) consisting of the following mixtures:

(I-749)+(1.002), (I-749)+(1.018), (I-749)+(1.020), (I-749)+(1.021), (I-749)+(1.055), (I-749)+(2.002), (I-749)+(2.005), (I-749)+(2.028), (I-749)+(2.038), (I-749)+(3.020), (I-749)+(3.025), (I-749)+(5.003), (I-749)+(5.010), (I-749)+(5.012), (I-749)+(5.013), (I-749)+(5.018), (I-749)+(6.002), (I-749)+(7.005), (I-749)+(13.001), (I-749)+(13.004), (I-749)+(13.005), (I-749)+(15.012), (I-749)+(15.016), (I-749)+(15.064) and (I-749)+(18.001).

If two compounds (B) are present in the combinations according to the invention, preferred compound combinations are selected from the group (G1-C) consisting of the following mixtures:

(I-655)+(1.001)+(1.002), (I-655)+(1.001)+(1.003), (I-655)+(1.001)+(1.004), (I-655)+(1.001)+(1.005), (I-655)+(1.001)+(1.006), (I-655)+(1.001)+(1.007), (I-655)+(1.001)+(1.008), (I-655)+(1.001)+(1.009), (I-655)+(1.001)+(1.010), (I-655)+(1.001)+(1.011), (I-655)+(1.001)+(1.012), (I-655)+(1.001)+(1.013), (I-655)+(1.001)+(1.014), (I-655)+(1.001)+(1.015), (I-655)+(1.001)+(1.016), (I-655)+(1.001)+(1.017), (I-655)+(1.001)+(1.018), (I-655)+(1.001)+(1.019), (I-655)+(1.001)+(1.020), (I-655)+(1.001)+(1.021), (I-655)+(1.001)+(1.022), (I-655)+(1.001)+(1.023), (I-655)+(1.001)+(1.024), (I-655)+(1.001)+(1.025), (I-655)+(1.001)+(1.026), (I-655)+(1.001)+(1.027), (I-655)+(1.001)+(1.028), (I-655)+(1.001)+(1.029), (I-655)+(1.001)+(1.030), (I-655)+(1.001)+(1.031), (I-655)+(1.001)+(1.032), (I-655)+(1.001)+(1.033), (I-655)+(1.001)+(1.034), (I-655)+(1.001)+(1.035), (I-655)+(1.001)+(1.036), (I-655)+(1.001)+(1.037), (I-655)+(1.001)+(1.038), (I-655)+(1.001)+(1.039), (I-655)+(1.001)+(1.040), (I-655)+(1.001)+(1.041), (I-655)+(1.001)+(1.042), (I-655)+(1.001)+(1.043), (I-655)+(1.001)+(1.044), (I-655)+(1.001)+(1.045), (I-655)+(1.001)+(1.046), (I-655)+(1.001)+(1.047), (I-655)+(1.001)+(1.048), (I-655)+(1.001)+(1.049), (I-655)+(1.001)+(1.050), (I-655)+(1.001)+(1.051), (I-655)+(1.001)+(1.052), (I-655)+(1.001)+(1.053), (I-655)+(1.001)+(1.054), (I-655)+(1.001)+(1.055), (I-655)+(1.001)+(1.056), (I-655)+(1.001)+(1.057), (I-655)+(1.001)+(1.058), (I-655)+(1.001)+(1.059), (I-655)+(1.001)+(1.060), (I-655)+(1.001)+(1.061), (I-655)+(1.001)+(1.062), (I-655)+(1.001)+(1.063), (I-655)+(1.001)+(1.064), (I-655)+(1.001)+(1.065), (I-655)+(1.001)+(1.066), (I-655)+(1.001)+(1.067), (I-655)+(1.001)+(1.068), (I-655)+(1.001)+(1.069), (I-655)+(1.001)+(1.070), (I-655)+(1.001)+(1.071), (I-655)+(1.001)+(1.072), (I-655)+(1.001)+(1.073), (I-655)+(1.001)+(1.074), (I-655)+(1.001)+(1.075), (I-655)+(1.001)+(1.076), (I-655)+(1.001)+(1.077), (I-655)+(1.001)+(1.078), (I-655)+(1.001)+(1.079), (I-655)+(1.001)+(1.080), (I-655)+(1.001)+(1.081), (I-655)+(1.001)+(1.082), (I-655)+(1.001)+(1.083), (I-655)+(1.001)+(1.084), (I-655)+(1.001)+(1.085), (I-655)+(1.001)+(1.086), (I-655)+(1.001)+(1.087), (I-655)+(1.001)+(1.088), (I-655)+(1.001)+(1.089), (I-655)+(1.001)+(1.090), (I-655)+(1.001)+(1.091), (I-655)+(1.001)+(1.092), (I-655)+(1.001)+(2.001), (I-655)+(1.001)+(2.002), (I-655)+(1.001)+(2.003), (I-655)+(1.001)+(2.004), (I-655)+(1.001)+(2.005), (I-655)+(1.001)+(2.006), (I-655)+(1.001)+(2.007), (I-655)+(1.001)+(2.008), (I-655)+(1.001)+(2.009), (I-655)+(1.001)+(2.010), (I-655)+(1.001)+(2.011), (I-655)+(1.001)+(2.012), (I-655)+(1.001)+(2.013), (I-655)+(1.001)+(2.014), (I-655)+(1.001)+(2.015), (I-655)+(1.001)+(2.016), (I-655)+(1.001)+(2.017), (I-655)+(1.001)+(2.018), (I-655)+(1.001)+(2.019), (I-655)+(1.001)+(2.020), (I-655)+(1.001)+(2.021), (I-655)+(1.001)+(2.022), (I-655)+(1.001)+(2.023), (I-655)+(1.001)+(2.024), (I-655)+(1.001)+(2.025), (I-655)+(1.001)+(2.026), (I-655)+(1.001)+(2.027), (I-655)+(1.001)+(2.028), (I-655)+(1.001)+(2.029), (I-655)+(1.001)+(2.030), (I-655)+(1.001)+(2.031), (I-655)+(1.001)+(2.032), (I-655)+(1.001)+(2.033), (I-655)+(1.001)+(2.034), (I-655)+(1.001)+(2.035), (I-655)+(1.001)+(2.036), (I-655)+(1.001)+(2.037), (I-655)+(1.001)+(2.038), (I-655)+(1.001)+(2.039), (I-655)+(1.001)+(2.040), (I-655)+(1.001)+(2.041), (I-655)+(1.001)+(2.042), (I-655)+(1.001)+(2.043), (I-655)+(1.001)+(2.044), (I-655)+(1.001)+(2.045), (I-655)+(1.001)+(2.046), (I-655)+(1.001)+(2.047), (I-655)+(1.001)+(2.048), (I-655)+(1.001)+(2.049), (I-655)+(1.001)+(2.050), (I-655)+(1.001)+(2.051), (I-655)+(1.001)+(2.052), (I-655)+(1.001)+(2.053), (I-655)+(1.001)+(2.054), (I-655)+(1.001)+(2.055), (I-655)+(1.001)+(2.056), (I-655)+(1.001)+(2.057), (I-655)+(1.001)+(2.058), (I-655)+(1.001)+(2.059), (I-655)+(1.001)+(3.001), (I-655)+(1.001)+(3.002), (I-655)+(1.001)+(3.003), (I-655)+(1.001)+(3.004), (I-655)+(1.001)+(3.005), (I-655)+(1.001)+(3.006), (I-655)+(1.001)+(3.007), (I-655)+(1.001)+(3.008), (I-655)+(1.001)+(3.009), (I-655)+(1.001)+(3.010), (I-655)+(1.001)+(3.011), (I-655)+(1.001)+(3.012), (I-655)+(1.001)+(3.013), (I-655)+(1.001)+(3.014), (I-655)+(1.001)+(3.015), (I-655)+(1.001)+(3.016), (I-655)+(1.001)+(3.017), (I-655)+(1.001)+(3.018), (I-655)+(1.001)+(3.019), (I-655)+(1.001)+(3.020), (I-655)+(1.001)+(3.021), (I-655)+(1.001)+(3.022), (I-655)+(1.001)+(3.023), (I-655)+(1.001)+(3.024), (I-655)+(1.001)+(3.025), (I-655)+(1.001)+(3.026), (I-655)+(1.001)+(3.027), (I-655)+(1.001)+(3.028), (I-655)+(1.001)+(3.029), (I-655)+(1.001)+(3.030), (I-655)+(1.001)+(3.031), (I-655)+(1.001)+(5.001), (I-655)+(1.001)+(5.002), (I-655)+(1.001)+(5.003), (I-655)+(1.001)+(5.004), (I-655)+(1.001)+(5.005), (I-655)+(1.001)+(5.006), (I-655)+(1.001)+(5.007), (I-655)+(1.001)+(5.008), (I-655)+(1.001)+(5.009), (I-655)+(1.001)+(5.010), (I-655)+(1.001)+(5.011), (I-655)+(1.001)+(5.012), (I-655)+(1.001)+(5.013), (I-655)+(1.001)+(5.014), (I-655)+(1.001)+(5.015), (I-655)+(1.001)+(5.016), (I-655)+(1.001)+(5.017), (I-655)+(1.001)+(5.018), (I-655)+(1.001)+(5.019), (I-655)+(1.001)+(5.020), (I-655)+(1.001)+(5.021), (I-655)+(1.001)+(5.022), (I-655)+(1.001)+(5.023), (I-655)+(1.001)+(6.001), (I-655)+(1.001)+(6.002), (I-655)+(1.001)+(6.003), (I-655)+(1.001)+(6.004), (I-655)+(1.001)+(7.001), (I-655)+(1.001)+(7.002), (I-655)+(1.001)+(7.003), (I-655)+(1.001)+(7.004), (I-655)+(1.001)+(7.005), (I-655)+(1.001)+(7.006), (I-655)+(1.001)+(9.001), (I-655)+(1.001)+(9.002), (I-655)+(1.001)+(9.003), (I-655)+(1.001)+(9.004), (I-655)+(1.001)+(9.005), (I-655)+(1.001)+(9.006), (I-655)+(1.001)+(9.007), (I-655)+(1.001)+(9.008), (I-655)+(1.001)+(9.009), (I-655)+(1.001)+(14.001), (I-655)+(1.001)+(14.002), (I-655)+(1.001)+(15.008), (I-655)+(1.001)+(15.011), (I-655)+(1.001)+(15.012), (I-655)+(1.001)+(15.016), (I-655)+(1.001)+(15.025), (I-655)+(1.001)+(15.027), (I-655)+(1.001)+(15.047), (I-655)+(1.001)+(15.063), (I-655)+(1.001)+(15.064), (I-655)+(1.001)+(16.001), (I-655)+(1.001)+(16.002), (I-655)+(1.001)+(16.003), (I-655)+(1.001)+(16.004), (I-655)+(1.001)+(16.005), (I-655)+(1.001)+(16.006), (I-655)+(1.001)+(16.007), (I-655)+(1.001)+(16.008), (I-655)+(1.001)+(17.001), (I-655)+(1.001)+(17.002), (I-655)+(1.001)+(17.003), (I-655)+(1.001)+(17.004), (I-655)+(1.001)+(17.005), (I-655)+(1.001)+(17.006), (I-655)+(1.001)+(17.007), (I-655)+(1.001)+(17.008), (I-655)+(1.001)+(17.009), (I-655)+(1.001)+(17.010), (I-655)+(1.001)+(17.011), (I-655)+(1.001)+(17.012), (I-655)+(1.001)+(18.001),

(I-655)+(1.002)+(1.003), (I-655)+(1.002)+(1.004), (I-655)+(1.002)+(1.005), (I-655)+(1.002)+(1.006), (I-655)+(1.002)+(1.007), (I-655)+(1.002)+(1.008), (I-655)+(1.002)+(1.009), (I-655)+(1.002)+(1.010), (I-655)+(1.002)+(1.011), (I-655)+(1.002)+(1.012), (I-655)+(1.002)+(1.013), (I-655)+(1.002)+(1.014), (I-655)+(1.002)+(1.015), (I-655)+(1.002)+(1.016), (I-655)+(1.002)+(1.017), (I-655)+(1.002)+(1.018), (I-655)+(1.002)+(1.019), (I-655)+(1.002)+(1.020), (I-655)+(1.002)+(1.021), (I-655)+(1.002)+(1.022), (I-655)+(1.002)+(1.023), (I-655)+(1.002)+(1.024), (I-655)+(1.002)+(1.025), (I-655)+(1.002)+(1.026), (I-655)+(1.002)+(1.027), (I-655)+(1.002)+(1.028), (I-655)+(1.002)+(1.029), (I-655)+(1.002)+(1.030), (I-655)+(1.002)+(1.031), (I-655)+(1.002)+(1.032), (I-655)+(1.002)+(1.033), (I-655)+(1.002)+(1.034), (I-655)+(1.002)+(1.035), (I-655)+(1.002)+(1.036), (I-655)+(1.002)+(1.037), (I-655)+(1.002)+(1.038), (I-655)+(1.002)+(1.039), (I-655)+(1.002)+(1.040), (I-655)+(1.002)+(1.041), (I-655)+(1.002)+(1.042), (I-655)+(1.002)+(1.043), (I-655)+(1.002)+(1.044), (I-655)+(1.002)+(1.045), (I-655)+(1.002)+(1.046), (I-655)+(1.002)+(1.047), (I-655)+(1.002)+(1.048), (I-655)+(1.002)+(1.049), (I-655)+(1.002)+(1.050), (I-655)+(1.002)+(1.051), (I-655)+(1.002)+(1.052), (I-655)+(1.002)+(1.053), (I-655)+(1.002)+(1.054), (I-655)+(1.002)+(1.055), (I-655)+(1.002)+(1.056), (I-655)+(1.002)+(1.057), (I-655)+(1.002)+(1.058), (I-655)+(1.002)+(1.059), (I-655)+(1.002)+(1.060), (I-655)+(1.002)+(1.061), (I-655)+(1.002)+(1.062), (I-655)+(1.002)+(1.063), (I-655)+(1.002)+(1.064), (I-655)+(1.002)+(1.065), (I-655)+(1.002)+(1.066), (I-655)+(1.002)+(1.067), (I-655)+(1.002)+(1.068), (I-655)+(1.002)+(1.069), (I-655)+(1.002)+(1.070), (I-655)+(1.002)+(1.071), (I-655)+(1.002)+(1.072), (I-655)+(1.002)+(1.073), (I-655)+(1.002)+(1.074), (I-655)+(1.002)+(1.075), (I-655)+(1.002)+(1.076), (I-655)+(1.002)+(1.077), (I-655)+(1.002)+(1.078), (I-655)+(1.002)+(1.079), (I-655)+(1.002)+(1.080), (I-655)+(1.002)+(1.081), (I-655)+(1.002)+(1.082), (I-655)+(1.002)+(1.083), (I-655)+(1.002)+(1.084), (I-655)+(1.002)+(1.085), (I-655)+(1.002)+(1.086), (I-655)+(1.002)+(1.087), (I-655)+(1.002)+(1.088), (I-655)+(1.002)+(1.089), (I-655)+(1.002)+(1.090), (I-655)+(1.002)+(1.091), (I-655)+(1.002)+(1.092), (I-655)+(1.002)+(2.001), (I-655)+(1.002)+(2.002), (I-655)+(1.002)+(2.003), (I-655)+(1.002)+(2.004), (I-655)+(1.002)+(2.005), (I-655)+(1.002)+(2.006), (I-655)+(1.002)+(2.007), (I-655)+(1.002)+(2.008), (I-655)+(1.002)+(2.009), (I-655)+(1.002)+(2.010), (I-655)+(1.002)+(2.011), (I-655)+(1.002)+(2.012), (I-655)+(1.002)+(2.013), (I-655)+(1.002)+(2.014), (I-655)+(1.002)+(2.015), (I-655)+(1.002)+(2.016), (I-655)+(1.002)+(2.017), (I-655)+(1.002)+(2.018), (I-655)+(1.002)+(2.019), (I-655)+(1.002)+(2.020), (I-655)+(1.002)+(2.021), (I-655)+(1.002)+(2.022), (I-655)+(1.002)+(2.023), (I-655)+(1.002)+(2.024), (I-655)+(1.002)+(2.025), (I-655)+(1.002)+(2.026), (I-655)+(1.002)+(2.027), (I-655)+(1.002)+(2.028), (I-655)+(1.002)+(2.029), (I-655)+(1.002)+(2.030), (I-655)+(1.002)+(2.031), (I-655)+(1.002)+(2.032), (I-655)+(1.002)+(2.033), (I-655)+(1.002)+(2.034), (I-655)+(1.002)+(2.035), (I-655)+(1.002)+(2.036), (I-655)+(1.002)+(2.037), (I-655)+(1.002)+(2.038), (I-655)+(1.002)+(2.039), (I-655)+(1.002)+(2.040), (I-655)+(1.002)+(2.041), (I-655)+(1.002)+(2.042), (I-655)+(1.002)+(2.043), (I-655)+(1.002)+(2.044), (I-655)+(1.002)+(2.045), (I-655)+(1.002)+(2.046), (I-655)+(1.002)+(2.047), (I-655)+(1.002)+(2.048), (I-655)+(1.002)+(2.049), (I-655)+(1.002)+(2.050), (I-655)+(1.002)+(2.051), (I-655)+(1.002)+(2.052), (I-655)+(1.002)+(2.053), (I-655)+(1.002)+(2.054), (I-655)+(1.002)+(2.055), (I-655)+(1.002)+(2.056), (I-655)+(1.002)+(2.057), (I-655)+(1.002)+(2.058), (I-655)+(1.002)+(2.059), (I-655)+(1.002)+(3.001), (I-655)+(1.002)+(3.002), (I-655)+(1.002)+(3.003), (I-655)+(1.002)+(3.004), (I-655)+(1.002)+(3.005), (I-655)+(1.002)+(3.006), (I-655)+(1.002)+(3.007), (I-655)+(1.002)+(3.008), (I-655)+(1.002)+(3.009), (I-655)+(1.002)+(3.010), (I-655)+(1.002)+(3.011), (I-655)+(1.002)+(3.012), (I-655)+(1.002)+(3.013), (I-655)+(1.002)+(3.014), (I-655)+(1.002)+(3.015), (I-655)+(1.002)+(3.016), (I-655)+(1.002)+(3.017), (I-655)+(1.002)+(3.018), (I-655)+(1.002)+(3.019), (I-655)+(1.002)+(3.020), (I-655)+(1.002)+(3.021), (I-655)+(1.002)+(3.022), (I-655)+(1.002)+(3.023), (I-655)+(1.002)+(3.024), (I-655)+(1.002)+(3.025), (I-655)+(1.002)+(3.026), (I-655)+(1.002)+(3.027), (I-655)+(1.002)+(3.028), (I-655)+(1.002)+(3.029), (I-655)+(1.002)+(3.030), (I-655)+(1.002)+(3.031), (I-655)+(1.002)+(5.001), (I-655)+(1.002)+(5.002), (I-655)+(1.002)+(5.003), (I-655)+(1.002)+(5.004), (I-655)+(1.002)+(5.005), (I-655)+(1.002)+(5.006), (I-655)+(1.002)+(5.007), (I-655)+(1.002)+(5.008), (I-655)+(1.002)+(5.009), (I-655)+(1.002)+(5.010), (I-655)+(1.002)+(5.011), (I-655)+(1.002)+(5.012), (I-655)+(1.002)+(5.013), (I-655)+(1.002)+(5.014), (I-655)+(1.002)+(5.015), (I-655)+(1.002)+(5.016), (I-655)+(1.002)+(5.017), (I-655)+(1.002)+(5.018), (I-655)+(1.002)+(5.019), (I-655)+(1.002)+(5.020), (I-655)+(1.002)+(5.021), (I-655)+(1.002)+(5.022), (I-655)+(1.002)+(5.023), (I-655)+(1.002)+(6.001), (I-655)+(1.002)+(6.002), (I-655)+(1.002)+(6.003), (I-655)+(1.002)+(6.004), (I-655)+(1.002)+(7.001), (I-655)+(1.002)+(7.002), (I-655)+(1.002)+(7.003), (I-655)+(1.002)+(7.004), (I-655)+(1.002)+(7.005), (I-655)+(1.002)+(7.006), (I-655)+(1.002)+(9.001), (I-655)+(1.002)+(9.002), (I-655)+(1.002)+(9.003), (I-655)+(1.002)+(9.004), (I-655)+(1.002)+(9.005), (I-655)+(1.002)+(9.006), (I-655)+(1.002)+(9.007), (I-655)+(1.002)+(9.008), (I-655)+(1.002)+(9.009), (I-655)+(1.002)+(14.001), (I-655)+(1.002)+(14.002), (I-655)+(1.002)+(15.008), (I-655)+(1.002)+(15.011), (I-655)+(1.002)+(15.012), (I-655)+(1.002)+(15.016), (I-655)+(1.002)+(15.025), (I-655)+(1.002)+(15.027), (I-655)+(1.002)+(15.047), (I-655)+(1.002)+(15.063), (I-655)+(1.002)+(15.064), (I-655)+(1.002)+(16.001), (I-655)+(1.002)+(16.002), (I-655)+(1.002)+(16.003), (I-655)+(1.002)+(16.004), (I-655)+(1.002)+(16.005), (I-655)+(1.002)+(16.006), (I-655)+(1.002)+(16.007), (I-655)+(1.002)+(16.008), (I-655)+(1.002)+(17.001), (I-655)+(1.002)+(17.002), (I-655)+(1.002)+(17.003), (I-655)+(1.002)+(17.004), (I-655)+(1.002)+(17.005), (I-655)+(1.002)+(17.006), (I-655)+(1.002)+(17.007), (I-655)+(1.002)+(17.008), (I-655)+(1.002)+(17.009), (I-655)+(1.002)+(17.010), (I-655)+(1.002)+(17.011), (I-655)+(1.002)+(17.012), (I-655)+(1.002)+(18.001),

(I-655)+(1.003)+(1.004), (I-655)+(1.003)+(1.005), (I-655)+(1.003)+(1.006), (I-655)+(1.003)+(1.007), (I-655)+(1.003)+(1.008), (I-655)+(1.003)+(1.009), (I-655)+(1.003)+(1.010), (I-655)+(1.003)+(1.011), (I-655)+(1.003)+(1.012), (I-655)+(1.003)+(1.013), (I-655)+(1.003)+(1.014), (I-655)+(1.003)+(1.015), (I-655)+(1.003)+(1.016), (I-655)+(1.003)+(1.017), (I-655)+(1.003)+(1.018), (I-655)+(1.003)+(1.019), (I-655)+(1.003)+(1.020), (I-655)+(1.003)+(1.021), (I-655)+(1.003)+(1.022), (I-655)+(1.003)+(1.023), (I-655)+(1.003)+(1.024), (I-655)+(1.003)+(1.025), (I-655)+(1.003)+(1.026), (I-655)+(1.003)+(1.027), (I-655)+(1.003)+(1.028), (I-655)+(1.003)+(1.029), (I-655)+(1.003)+(1.030), (I-655)+(1.003)+(1.031), (I-655)+(1.003)+(1.032), (I-655)+(1.003)+(1.033), (I-655)+(1.003)+(1.034), (I-655)+(1.003)+(1.035), (I-655)+(1.003)+(1.036), (I-655)+(1.003)+(1.037), (I-655)+(1.003)+(1.038), (I-655)+(1.003)+(1.039), (I-655)+(1.003)+(1.040), (I-655)+(1.003)+(1.041), (I-655)+(1.003)+(1.042), (I-655)+(1.003)+(1.043), (I-655)+(1.003)+(1.044), (I-655)+(1.003)+(1.045), (I-655)+(1.003)+(1.046), (I-655)+(1.003)+(1.047), (I-655)+(1.003)+(1.048), (I-655)+(1.003)+(1.049), (I-655)+(1.003)+(1.050), (I-655)+(1.003)+(1.051), (I-655)+(1.003)+(1.052), (I-655)+(1.003)+(1.053), (I-655)+(1.003)+(1.054), (I-655)+(1.003)+(1.055), (I-655)+(1.003)+(1.056), (I-655)+(1.003)+(1.057), (I-655)+(1.003)+(1.058), (I-655)+(1.003)+(1.059), (I-655)+(1.003)+(1.060), (I-655)+(1.003)+(1.061), (I-655)+(1.003)+(1.062), (I-655)+(1.003)+(1.063), (I-655)+(1.003)+(1.064), (I-655)+(1.003)+(1.065), (I-655)+(1.003)+(1.066), (I-655)+(1.003)+(1.067), (I-655)+(1.003)+(1.068), (I-655)+(1.003)+(1.069), (I-655)+(1.003)+(1.070), (I-655)+(1.003)+(1.071), (I-655)+(1.003)+(1.072), (I-655)+(1.003)+(1.073), (I-655)+(1.003)+(1.074), (I-655)+(1.003)+(1.075), (I-655)+(1.003)+(1.076), (I-655)+(1.003)+(1.077), (I-655)+(1.003)+(1.078), (I-655)+(1.003)+(1.079), (I-655)+(1.003)+(1.080), (I-655)+(1.003)+(1.081), (I-655)+(1.003)+(1.082), (I-655)+(1.003)+(1.083), (I-655)+(1.003)+(1.084), (I-655)+(1.003)+(1.085), (I-655)+(1.003)+(1.086), (I-655)+(1.003)+(1.087), (I-655)+(1.003)+(1.088), (I-655)+(1.003)+(1.089), (I-655)+(1.003)+(1.090), (I-655)+(1.003)+(1.091), (I-655)+(1.003)+(1.092), (I-655)+(1.003)+(2.001), (I-655)+(1.003)+(2.002), (I-655)+(1.003)+(2.003), (I-655)+(1.003)+(2.004), (I-655)+(1.003)+(2.005), (I-655)+(1.003)+(2.006), (I-655)+(1.003)+(2.007), (I-655)+(1.003)+(2.008), (I-655)+(1.003)+(2.009), (I-655)+(1.003)+(2.010), (I-655)+(1.003)+(2.011), (I-655)+(1.003)+(2.012), (I-655)+(1.003)+(2.013), (I-655)+(1.003)+(2.014), (I-655)+(1.003)+(2.015), (I-655)+(1.003)+(2.016), (I-655)+(1.003)+(2.017), (I-655)+(1.003)+(2.018), (I-655)+(1.003)+(2.019), (I-655)+(1.003)+(2.020), (I-655)+(1.003)+(2.021), (I-655)+(1.003)+(2.022), (I-655)+(1.003)+(2.023), (I-655)+(1.003)+(2.024), (I-655)+(1.003)+(2.025), (I-655)+(1.003)+(2.026), (I-655)+(1.003)+(2.027), (I-655)+(1.003)+(2.028), (I-655)+(1.003)+(2.029), (I-655)+(1.003)+(2.030), (I-655)+(1.003)+(2.031), (I-655)+(1.003)+(2.032), (I-655)+(1.003)+(2.033), (I-655)+(1.003)+(2.034), (I-655)+(1.003)+(2.035), (I-655)+(1.003)+(2.036), (I-655)+(1.003)+(2.037), (I-655)+(1.003)+(2.038), (I-655)+(1.003)+(2.039), (I-655)+(1.003)+(2.040), (I-655)+(1.003)+(2.041), (I-655)+(1.003)+(2.042), (I-655)+(1.003)+(2.043), (I-655)+(1.003)+(2.044), (I-655)+(1.003)+(2.045), (I-655)+(1.003)+(2.046), (I-655)+(1.003)+(2.047), (I-655)+(1.003)+(2.048), (I-655)+(1.003)+(2.049), (I-655)+(1.003)+(2.050), (I-655)+(1.003)+(2.051), (I-655)+(1.003)+(2.052), (I-655)+(1.003)+(2.053), (I-655)+(1.003)+(2.054), (I-655)+(1.003)+(2.055), (I-655)+(1.003)+(2.056), (I-655)+(1.003)+(2.057), (I-655)+(1.003)+(2.058), (I-655)+(1.003)+(2.059), (I-655)+(1.003)+(3.001), (I-655)+(1.003)+(3.002), (I-655)+(1.003)+(3.003), (I-655)+(1.003)+(3.004), (I-655)+(1.003)+(3.005), (I-655)+(1.003)+(3.006), (I-655)+(1.003)+(3.007), (I-655)+(1.003)+(3.008), (I-655)+(1.003)+(3.009), (I-655)+(1.003)+(3.010), (I-655)+(1.003)+(3.011), (I-655)+(1.003)+(3.012), (I-655)+(1.003)+(3.013), (I-655)+(1.003)+(3.014), (I-655)+(1.003)+(3.015), (I-655)+(1.003)+(3.016), (I-655)+(1.003)+(3.017), (I-655)+(1.003)+(3.018), (I-655)+(1.003)+(3.019), (I-655)+(1.003)+(3.020), (I-655)+(1.003)+(3.021), (I-655)+(1.003)+(3.022), (I-655)+(1.003)+(3.023), (I-655)+(1.003)+(3.024), (I-655)+(1.003)+(3.025), (I-655)+(1.003)+(3.026), (I-655)+(1.003)+(3.027), (I-655)+(1.003)+(3.028), (I-655)+(1.003)+(3.029), (I-655)+(1.003)+(3.030), (I-655)+(1.003)+(3.031), (I-655)+(1.003)+(5.001), (I-655)+(1.003)+(5.002), (I-655)+(1.003)+(5.003), (I-655)+(1.003)+(5.004), (I-655)+(1.003)+(5.005), (I-655)+(1.003)+(5.006), (I-655)+(1.003)+(5.007), (I-655)+(1.003)+(5.008), (I-655)+(1.003)+(5.009), (I-655)+(1.003)+(5.010), (I-655)+(1.003)+(5.011), (I-655)+(1.003)+(5.012), (I-655)+(1.003)+(5.013), (I-655)+(1.003)+(5.014), (I-655)+(1.003)+(5.015), (I-655)+(1.003)+(5.016), (I-655)+(1.003)+(5.017), (I-655)+(1.003)+(5.018), (I-655)+(1.003)+(5.019), (I-655)+(1.003)+(5.020), (I-655)+(1.003)+(5.021), (I-655)+(1.003)+(5.022), (I-655)+(1.003)+(5.023), (I-655)+(1.003)+(6.001), (I-655)+(1.003)+(6.002), (I-655)+(1.003)+(6.003), (I-655)+(1.003)+(6.004), (I-655)+(1.003)+(7.001), (I-655)+(1.003)+(7.002), (I-655)+(1.003)+(7.003), (I-655)+(1.003)+(7.004), (I-655)+(1.003)+(7.005), (I-655)+(1.003)+(7.006), (I-655)+(1.003)+(9.001), (I-655)+(1.003)+(9.002), (I-655)+(1.003)+(9.003), (I-655)+(1.003)+(9.004), (I-655)+(1.003)+(9.005), (I-655)+(1.003)+(9.006), (I-655)+(1.003)+(9.007), (I-655)+(1.003)+(9.008), (I-655)+(1.003)+(9.009), (I-655)+(1.003)+(14.001), (I-655)+(1.003)+(14.002), (I-655)+(1.003)+(15.008), (I-655)+(1.003)+(15.011), (I-655)+(1.003)+(15.012), (I-655)+(1.003)+(15.016), (I-655)+(1.003)+(15.025), (I-655)+(1.003)+(15.027), (I-655)+(1.003)+(15.047), (I-655)+(1.003)+(15.063), (I-655)+(1.003)+(15.064), (I-655)+(1.003)+(16.001), (I-655)+(1.003)+(16.002), (I-655)+(1.003)+(16.003), (I-655)+(1.003)+(16.004), (I-655)+(1.003)+(16.005), (I-655)+(1.003)+(16.006), (I-655)+(1.003)+(16.007), (I-655)+(1.003)+(16.008), (I-655)+(1.003)+(17.001), (I-655)+(1.003)+(17.002), (I-655)+(1.003)+(17.003), (I-655)+(1.003)+(17.004), (I-655)+(1.003)+(17.005), (I-655)+(1.003)+(17.006), (I-655)+(1.003)+(17.007), (I-655)+(1.003)+(17.008), (I-655)+(1.003)+(17.009), (I-655)+(1.003)+(17.010), (I-655)+(1.003)+(17.011), (I-655)+(1.003)+(17.012), (I-655)+(1.003)+(18.001),

(I-655)+(1.004)+(1.005), (I-655)+(1.004)+(1.006), (I-655)+(1.004)+(1.007), (I-655)+(1.004)+(1.008), (I-655)+(1.004)+(1.009), (I-655)+(1.004)+(1.010), (I-655)+(1.004)+(1.011), (I-655)+(1.004)+(1.012), (I-655)+(1.004)+(1.013), (I-655)+(1.004)+(1.014), (I-655)+(1.004)+(1.015), (I-655)+(1.004)+(1.016), (I-655)+(1.004)+(1.017), (I-655)+(1.004)+(1.018), (I-655)+(1.004)+(1.019), (I-655)+(1.004)+(1.020), (I-655)+(1.004)+(1.021), (I-655)+(1.004)+(1.022), (I-655)+(1.004)+(1.023), (I-655)+(1.004)+(1.024), (I-655)+(1.004)+(1.025), (I-655)+(1.004)+(1.026), (I-655)+(1.004)+(1.027), (I-655)+(1.004)+(1.028), (I-655)+(1.004)+(1.029), (I-655)+(1.004)+(1.030), (I-655)+(1.004)+(1.031), (I-655)+(1.004)+(1.032), (I-655)+(1.004)+(1.033), (I-655)+(1.004)+(1.034), (I-655)+(1.004)+(1.035), (I-655)+(1.004)+(1.036), (I-655)+(1.004)+(1.037), (I-655)+(1.004)+(1.038), (I-655)+(1.004)+(1.039), (I-655)+(1.004)+(1.040), (I-655)+(1.004)+(1.041), (I-655)+(1.004)+(1.042), (I-655)+(1.004)+(1.043), (I-655)+(1.004)+(1.044), (I-655)+(1.004)+(1.045), (I-655)+(1.004)+(1.046), (I-655)+(1.004)+(1.047), (I-655)+(1.004)+(1.048), (I-655)+(1.004)+(1.049), (I-655)+(1.004)+(1.050), (I-655)+(1.004)+(1.051), (I-655)+(1.004)+(1.052), (I-655)+(1.004)+(1.053), (I-655)+(1.004)+(1.054), (I-655)+(1.004)+(1.055), (I-655)+(1.004)+(1.056), (I-655)+(1.004)+(1.057), (I-655)+(1.004)+(1.058), (I-655)+(1.004)+(1.059), (I-655)+(1.004)+(1.060), (I-655)+(1.004)+(1.061), (I-655)+(1.004)+(1.062), (I-655)+(1.004)+(1.063), (I-655)+(1.004)+(1.064), (I-655)+(1.004)+(1.065), (I-655)+(1.004)+(1.066), (I-655)+(1.004)+(1.067), (I-655)+(1.004)+(1.068), (I-655)+(1.004)+(1.069), (I-655)+(1.004)+(1.070), (I-655)+(1.004)+(1.071), (I-655)+(1.004)+(1.072), (I-655)+(1.004)+(1.073), (I-655)+(1.004)+(1.074), (I-655)+(1.004)+(1.075), (I-655)+(1.004)+(1.076), (I-655)+(1.004)+(1.077), (I-655)+(1.004)+(1.078), (I-655)+(1.004)+(1.079), (I-655)+(1.004)+(1.080), (I-655)+(1.004)+(1.081), (I-655)+(1.004)+(1.082), (I-655)+(1.004)+(1.083), (I-655)+(1.004)+(1.084), (I-655)+(1.004)+(1.085), (I-655)+(1.004)+(1.086), (I-655)+(1.004)+(1.087), (I-655)+(1.004)+(1.088), (I-655)+(1.004)+(1.089), (I-655)+(1.004)+(1.090), (I-655)+(1.004)+(1.091), (I-655)+(1.004)+(1.092), (I-655)+(1.004)+(2.001), (I-655)+(1.004)+(2.002), (I-655)+(1.004)+(2.003), (I-655)+(1.004)+(2.004), (I-655)+(1.004)+(2.005), (I-655)+(1.004)+(2.006), (I-655)+(1.004)+(2.007), (I-655)+(1.004)+(2.008), (I-655)+(1.004)+(2.009), (I-655)+(1.004)+(2.010), (I-655)+(1.004)+(2.011), (I-655)+(1.004)+(2.012), (I-655)+(1.004)+(2.013), (I-655)+(1.004)+(2.014), (I-655)+(1.004)+(2.015), (I-655)+(1.004)+(2.016), (I-655)+(1.004)+(2.017), (I-655)+(1.004)+(2.018), (I-655)+(1.004)+(2.019), (I-655)+(1.004)+(2.020), (I-655)+(1.004)+(2.021), (I-655)+(1.004)+(2.022), (I-655)+(1.004)+(2.023), (I-655)+(1.004)+(2.024), (I-655)+(1.004)+(2.025), (I-655)+(1.004)+(2.026), (I-655)+(1.004)+(2.027), (I-655)+(1.004)+(2.028), (I-655)+(1.004)+(2.029), (I-655)+(1.004)+(2.030), (I-655)+(1.004)+(2.031), (I-655)+(1.004)+(2.032), (I-655)+(1.004)+(2.033), (I-655)+(1.004)+(2.034), (I-655)+(1.004)+(2.035), (I-655)+(1.004)+(2.036), (I-655)+(1.004)+(2.037), (I-655)+(1.004)+(2.038), (I-655)+(1.004)+(2.039), (I-655)+(1.004)+(2.040), (I-655)+(1.004)+(2.041), (I-655)+(1.004)+(2.042), (I-655)+(1.004)+(2.043), (I-655)+(1.004)+(2.044), (I-655)+(1.004)+(2.045), (I-655)+(1.004)+(2.046), (I-655)+(1.004)+(2.047), (I-655)+(1.004)+(2.048), (I-655)+(1.004)+(2.049), (I-655)+(1.004)+(2.050), (I-655)+(1.004)+(2.051), (I-655)+(1.004)+(2.052), (I-655)+(1.004)+(2.053), (I-655)+(1.004)+(2.054), (I-655)+(1.004)+(2.055), (I-655)+(1.004)+(2.056), (I-655)+(1.004)+(2.057), (I-655)+(1.004)+(2.058), (I-655)+(1.004)+(2.059), (I-655)+(1.004)+(3.001), (I-655)+(1.004)+(3.002), (I-655)+(1.004)+(3.003), (I-655)+(1.004)+(3.004), (I-655)+(1.004)+(3.005), (I-655)+(1.004)+(3.006), (I-655)+(1.004)+(3.007), (I-655)+(1.004)+(3.008), (I-655)+(1.004)+(3.009), (I-655)+(1.004)+(3.010), (I-655)+(1.004)+(3.011), (I-655)+(1.004)+(3.012), (I-655)+(1.004)+(3.013), (I-655)+(1.004)+(3.014), (I-655)+(1.004)+(3.015), (I-655)+(1.004)+(3.016), (I-655)+(1.004)+(3.017), (I-655)+(1.004)+(3.018), (I-655)+(1.004)+(3.019), (I-655)+(1.004)+(3.020), (I-655)+(1.004)+(3.021), (I-655)+(1.004)+(3.022), (I-655)+(1.004)+(3.023), (I-655)+(1.004)+(3.024), (I-655)+(1.004)+(3.025), (I-655)+(1.004)+(3.026), (I-655)+(1.004)+(3.027), (I-655)+(1.004)+(3.028), (I-655)+(1.004)+(3.029), (I-655)+(1.004)+(3.030), (I-655)+(1.004)+(3.031), (I-655)+(1.004)+(5.001), (I-655)+(1.004)+(5.002), (I-655)+(1.004)+(5.003), (I-655)+(1.004)+(5.004), (I-655)+(1.004)+(5.005), (I-655)+(1.004)+(5.006), (I-655)+(1.004)+(5.007), (I-655)+(1.004)+(5.008), (I-655)+(1.004)+(5.009), (I-655)+(1.004)+(5.010), (I-655)+(1.004)+(5.011), (I-655)+(1.004)+(5.012), (I-655)+(1.004)+(5.013), (I-655)+(1.004)+(5.014), (I-655)+(1.004)+(5.015), (I-655)+(1.004)+(5.016), (I-655)+(1.004)+(5.017), (I-655)+(1.004)+(5.018), (I-655)+(1.004)+(5.019), (I-655)+(1.004)+(5.020), (I-655)+(1.004)+(5.021), (I-655)+(1.004)+(5.022), (I-655)+(1.004)+(5.023), (I-655)+(1.004)+(6.001), (I-655)+(1.004)+(6.002), (I-655)+(1.004)+(6.003), (I-655)+(1.004)+(6.004), (I-655)+(1.004)+(7.001), (I-655)+(1.004)+(7.002), (I-655)+(1.004)+(7.003), (I-655)+(1.004)+(7.004), (I-655)+(1.004)+(7.005), (I-655)+(1.004)+(7.006), (I-655)+(1.004)+(9.001), (I-655)+(1.004)+(9.002), (I-655)+(1.004)+(9.003), (I-655)+(1.004)+(9.004), (I-655)+(1.004)+(9.005), (I-655)+(1.004)+(9.006), (I-655)+(1.004)+(9.007), (I-655)+(1.004)+(9.008), (I-655)+(1.004)+(9.009), (I-655)+(1.004)+(14.001), (I-655)+(1.004)+(14.002), (I-655)+(1.004)+(15.008), (I-655)+(1.004)+(15.011), (I-655)+(1.004)+(15.012), (I-655)+(1.004)+(15.016), (I-655)+(1.004)+(15.025), (I-655)+(1.004)+(15.027), (I-655)+(1.004)+(15.047), (I-655)+(1.004)+(15.063), (I-655)+(1.004)+(15.064), (I-655)+(1.004)+(16.001), (I-655)+(1.004)+(16.002), (I-655)+(1.004)+(16.003), (I-655)+(1.004)+(16.004), (I-655)+(1.004)+(16.005), (I-655)+(1.004)+(16.006), (I-655)+(1.004)+(16.007), (I-655)+(1.004)+(16.008), (I-655)+(1.004)+(17.001), (I-655)+(1.004)+(17.002), (I-655)+(1.004)+(17.003), (I-655)+(1.004)+(17.004), (I-655)+(1.004)+(17.005), (I-655)+(1.004)+(17.006), (I-655)+(1.004)+(17.007), (I-655)+(1.004)+(17.008), (I-655)+(1.004)+(17.009), (I-655)+(1.004)+(17.010), (I-655)+(1.004)+(17.011), (I-655)+(1.004)+(17.012), (I-655)+(1.004)+(18.001),

(I-655)+(1.005)+(1.006), (I-655)+(1.005)+(1.007), (I-655)+(1.005)+(1.008), (I-655)+(1.005)+(1.009), (I-655)+(1.005)+(1.010), (I-655)+(1.005)+(1.011), (I-655)+(1.005)+(1.012), (I-655)+(1.005)+(1.013), (I-655)+(1.005)+(1.014), (I-655)+(1.005)+(1.015), (I-655)+(1.005)+(1.016), (I-655)+(1.005)+(1.017), (I-655)+(1.005)+(1.018), (I-655)+(1.005)+(1.019), (I-655)+(1.005)+(1.020), (I-655)+(1.005)+(1.021), (I-655)+(1.005)+(1.022), (I-655)+(1.005)+(1.023), (I-655)+(1.005)+(1.024), (I-655)+(1.005)+(1.025), (I-655)+(1.005)+(1.026), (I-655)+(1.005)+(1.027), (I-655)+(1.005)+(1.028), (I-655)+(1.005)+(1.029), (I-655)+(1.005)+(1.030), (I-655)+(1.005)+(1.031), (I-655)+(1.005)+(1.032), (I-655)+(1.005)+(1.033), (I-655)+(1.005)+(1.034), (I-655)+(1.005)+(1.035), (I-655)+(1.005)+(1.036), (I-655)+(1.005)+(1.037), (I-655)+(1.005)+(1.038), (I-655)+(1.005)+(1.039), (I-655)+(1.005)+(1.040), (I-655)+(1.005)+(1.041), (I-655)+(1.005)+(1.042), (I-655)+(1.005)+(1.043), (I-655)+(1.005)+(1.044), (I-655)+(1.005)+(1.045), (I-655)+(1.005)+(1.046), (I-655)+(1.005)+(1.047), (I-655)+(1.005)+(1.048), (I-655)+(1.005)+(1.049), (I-655)+(1.005)+(1.050), (I-655)+(1.005)+(1.051), (I-655)+(1.005)+(1.052), (I-655)+(1.005)+(1.053), (I-655)+(1.005)+(1.054), (I-655)+(1.005)+(1.055), (I-655)+(1.005)+(1.056), (I-655)+(1.005)+(1.057), (I-655)+(1.005)+(1.058), (I-655)+(1.005)+(1.059), (I-655)+(1.005)+(1.060), (I-655)+(1.005)+(1.061), (I-655)+(1.005)+(1.062), (I-655)+(1.005)+(1.063), (I-655)+(1.005)+(1.064), (I-655)+(1.005)+(1.065), (I-655)+(1.005)+(1.066), (I-655)+(1.005)+(1.067), (I-655)+(1.005)+(1.068), (I-655)+(1.005)+(1.069), (I-655)+(1.005)+(1.070), (I-655)+(1.005)+(1.071), (I-655)+(1.005)+(1.072), (I-655)+(1.005)+(1.073), (I-655)+(1.005)+(1.074), (I-655)+(1.005)+(1.075), (I-655)+(1.005)+(1.076), (I-655)+(1.005)+(1.077), (I-655)+(1.005)+(1.078), (I-655)+(1.005)+(1.079), (I-655)+(1.005)+(1.080), (I-655)+(1.005)+(1.081), (I-655)+(1.005)+(1.082), (I-655)+(1.005)+(1.083), (I-655)+(1.005)+(1.084), (I-655)+(1.005)+(1.085), (I-655)+(1.005)+(1.086), (I-655)+(1.005)+(1.087), (I-655)+(1.005)+(1.088), (I-655)+(1.005)+(1.089), (I-655)+(1.005)+(1.090), (I-655)+(1.005)+(1.091), (I-655)+(1.005)+(1.092), (I-655)+(1.005)+(2.001), (I-655)+(1.005)+(2.002), (I-655)+(1.005)+(2.003), (I-655)+(1.005)+(2.004), (I-655)+(1.005)+(2.005), (I-655)+(1.005)+(2.006), (I-655)+(1.005)+(2.007), (I-655)+(1.005)+(2.008), (I-655)+(1.005)+(2.009), (I-655)+(1.005)+(2.010), (I-655)+(1.005)+(2.011), (I-655)+(1.005)+(2.012), (I-655)+(1.005)+(2.013), (I-655)+(1.005)+(2.014), (I-655)+(1.005)+(2.015), (I-655)+(1.005)+(2.016), (I-655)+(1.005)+(2.017), (I-655)+(1.005)+(2.018), (I-655)+(1.005)+(2.019), (I-655)+(1.005)+(2.020), (I-655)+(1.005)+(2.021), (I-655)+(1.005)+(2.022), (I-655)+(1.005)+(2.023), (I-655)+(1.005)+(2.024), (I-655)+(1.005)+(2.025), (I-655)+(1.005)+(2.026), (I-655)+(1.005)+(2.027), (I-655)+(1.005)+(2.028), (I-655)+(1.005)+(2.029), (I-655)+(1.005)+(2.030), (I-655)+(1.005)+(2.031), (I-655)+(1.005)+(2.032), (I-655)+(1.005)+(2.033), (I-655)+(1.005)+(2.034), (I-655)+(1.005)+(2.035), (I-655)+(1.005)+(2.036), (I-655)+(1.005)+(2.037), (I-655)+(1.005)+(2.038), (I-655)+(1.005)+(2.039), (I-655)+(1.005)+(2.040), (I-655)+(1.005)+(2.041), (I-655)+(1.005)+(2.042), (I-655)+(1.005)+(2.043), (I-655)+(1.005)+(2.044), (I-655)+(1.005)+(2.045), (I-655)+(1.005)+(2.046), (I-655)+(1.005)+(2.047), (I-655)+(1.005)+(2.048), (I-655)+(1.005)+(2.049), (I-655)+(1.005)+(2.050), (I-655)+(1.005)+(2.051), (I-655)+(1.005)+(2.052), (I-655)+(1.005)+(2.053), (I-655)+(1.005)+(2.054), (I-655)+(1.005)+(2.055), (I-655)+(1.005)+(2.056), (I-655)+(1.005)+(2.057), (I-655)+(1.005)+(2.058), (I-655)+(1.005)+(2.059), (I-655)+(1.005)+(3.001), (I-655)+(1.005)+(3.002), (I-655)+(1.005)+(3.003), (I-655)+(1.005)+(3.004), (I-655)+(1.005)+(3.005), (I-655)+(1.005)+(3.006), (I-655)+(1.005)+(3.007), (I-655)+(1.005)+(3.008), (I-655)+(1.005)+(3.009), (I-655)+(1.005)+(3.010), (I-655)+(1.005)+(3.011), (I-655)+(1.005)+(3.012), (I-655)+(1.005)+(3.013), (I-655)+(1.005)+(3.014), (I-655)+(1.005)+(3.015), (I-655)+(1.005)+(3.016), (I-655)+(1.005)+(3.017), (I-655)+(1.005)+(3.018), (I-655)+(1.005)+(3.019), (I-655)+(1.005)+(3.020), (I-655)+(1.005)+(3.021), (I-655)+(1.005)+(3.022), (I-655)+(1.005)+(3.023), (I-655)+(1.005)+(3.024), (I-655)+(1.005)+(3.025), (I-655)+(1.005)+(3.026), (I-655)+(1.005)+(3.027), (I-655)+(1.005)+(3.028), (I-655)+(1.005)+(3.029), (I-655)+(1.005)+(3.030), (I-655)+(1.005)+(3.031), (I-655)+(1.005)+(5.001), (I-655)+(1.005)+(5.002), (I-655)+(1.005)+(5.003), (I-655)+(1.005)+(5.004), (I-655)+(1.005)+(5.005), (I-655)+(1.005)+(5.006), (I-655)+(1.005)+(5.007), (I-655)+(1.005)+(5.008), (I-655)+(1.005)+(5.009), (I-655)+(1.005)+(5.010), (I-655)+(1.005)+(5.011), (I-655)+(1.005)+(5.012), (I-655)+(1.005)+(5.013), (I-655)+(1.005)+(5.014), (I-655)+(1.005)+(5.015), (I-655)+(1.005)+(5.016), (I-655)+(1.005)+(5.017), (I-655)+(1.005)+(5.018), (I-655)+(1.005)+(5.019), (I-655)+(1.005)+(5.020), (I-655)+(1.005)+(5.021), (I-655)+(1.005)+(5.022), (I-655)+(1.005)+(5.023), (I-655)+(1.005)+(6.001), (I-655)+(1.005)+(6.002), (I-655)+(1.005)+(6.003), (I-655)+(1.005)+(6.004), (I-655)+(1.005)+(7.001), (I-655)+(1.005)+(7.002), (I-655)+(1.005)+(7.003), (I-655)+(1.005)+(7.004), (I-655)+(1.005)+(7.005), (I-655)+(1.005)+(7.006), (I-655)+(1.005)+(9.001), (I-655)+(1.005)+(9.002), (I-655)+(1.005)+(9.003), (I-655)+(1.005)+(9.004), (I-655)+(1.005)+(9.005), (I-655)+(1.005)+(9.006), (I-655)+(1.005)+(9.007), (I-655)+(1.005)+(9.008), (I-655)+(1.005)+(9.009), (I-655)+(1.005)+(14.001), (I-655)+(1.005)+(14.002), (I-655)+(1.005)+(15.008), (I-655)+(1.005)+(15.011), (I-655)+(1.005)+(15.012), (I-655)+(1.005)+(15.016), (I-655)+(1.005)+(15.025), (I-655)+(1.005)+(15.027), (I-655)+(1.005)+(15.047), (I-655)+(1.005)+(15.063), (I-655)+(1.005)+(15.064), (I-655)+(1.005)+(16.001), (I-655)+(1.005)+(16.002), (I-655)+(1.005)+(16.003), (I-655)+(1.005)+(16.004), (I-655)+(1.005)+(16.005), (I-655)+(1.005)+(16.006), (I-655)+(1.005)+(16.007), (I-655)+(1.005)+(16.008), (I-655)+(1.005)+(17.001), (I-655)+(1.005)+(17.002), (I-655)+(1.005)+(17.003), (I-655)+(1.005)+(17.004), (I-655)+(1.005)+(17.005), (I-655)+(1.005)+(17.006), (I-655)+(1.005)+(17.007), (I-655)+(1.005)+(17.008), (I-655)+(1.005)+(17.009), (I-655)+(1.005)+(17.010), (I-655)+(1.005)+(17.011), (I-655)+(1.005)+(17.012), (I-655)+(1.005)+(18.001),

(I-655)+(1.006)+(1.007), (I-655)+(1.006)+(1.008), (I-655)+(1.006)+(1.009), (I-655)+(1.006)+(1.010), (I-655)+(1.006)+(1.011), (I-655)+(1.006)+(1.012), (I-655)+(1.006)+(1.013), (I-655)+(1.006)+(1.014), (I-655)+(1.006)+(1.015), (I-655)+(1.006)+(1.016), (I-655)+(1.006)+(1.017), (I-655)+(1.006)+(1.018), (I-655)+(1.006)+(1.019), (I-655)+(1.006)+(1.020), (I-655)+(1.006)+(1.021), (I-655)+(1.006)+(1.022), (I-655)+(1.006)+(1.023), (I-655)+(1.006)+(1.024), (I-655)+(1.006)+(1.025), (I-655)+(1.006)+(1.026), (I-655)+(1.006)+(1.027), (I-655)+(1.006)+(1.028), (I-655)+(1.006)+(1.029), (I-655)+(1.006)+(1.030), (I-655)+(1.006)+(1.031), (I-655)+(1.006)+(1.032), (I-655)+(1.006)+(1.033), (I-655)+(1.006)+(1.034), (I-655)+(1.006)+(1.035), (I-655)+(1.006)+(1.036), (I-655)+(1.006)+(1.037), (I-655)+(1.006)+(1.038), (I-655)+(1.006)+(1.039), (I-655)+(1.006)+(1.040), (I-655)+(1.006)+(1.041), (I-655)+(1.006)+(1.042), (I-655)+(1.006)+(1.043), (I-655)+(1.006)+(1.044), (I-655)+(1.006)+(1.045), (I-655)+(1.006)+(1.046), (I-655)+(1.006)+(1.047), (I-655)+(1.006)+(1.048), (I-655)+(1.006)+(1.049), (I-655)+(1.006)+(1.050), (I-655)+(1.006)+(1.051), (I-655)+(1.006)+(1.052), (I-655)+(1.006)+(1.053), (I-655)+(1.006)+(1.054), (I-655)+(1.006)+(1.055), (I-655)+(1.006)+(1.056), (I-655)+(1.006)+(1.057), (I-655)+(1.006)+(1.058), (I-655)+(1.006)+(1.059), (I-655)+(1.006)+(1.060), (I-655)+(1.006)+(1.061), (I-655)+(1.006)+(1.062), (I-655)+(1.006)+(1.063), (I-655)+(1.006)+(1.064), (I-655)+(1.006)+(1.065), (I-655)+(1.006)+(1.066), (I-655)+(1.006)+(1.067), (I-655)+(1.006)+(1.068), (I-655)+(1.006)+(1.069), (I-655)+(1.006)+(1.070), (I-655)+(1.006)+(1.071), (I-655)+(1.006)+(1.072), (I-655)+(1.006)+(1.073), (I-655)+(1.006)+(1.074), (I-655)+(1.006)+(1.075), (I-655)+(1.006)+(1.076), (I-655)+(1.006)+(1.077), (I-655)+(1.006)+(1.078), (I-655)+(1.006)+(1.079), (I-655)+(1.006)+(1.080), (I-655)+(1.006)+(1.081), (I-655)+(1.006)+(1.082), (I-655)+(1.006)+(1.083), (I-655)+(1.006)+(1.084), (I-655)+(1.006)+(1.085), (I-655)+(1.006)+(1.086), (I-655)+(1.006)+(1.087), (I-655)+(1.006)+(1.088), (I-655)+(1.006)+(1.089), (I-655)+(1.006)+(1.090), (I-655)+(1.006)+(1.091), (I-655)+(1.006)+(1.092), (I-655)+(1.006)+(2.001), (I-655)+(1.006)+(2.002), (I-655)+(1.006)+(2.003), (I-655)+(1.006)+(2.004), (I-655)+(1.006)+(2.005), (I-655)+(1.006)+(2.006), (I-655)+(1.006)+(2.007), (I-655)+(1.006)+(2.008), (I-655)+(1.006)+(2.009), (I-655)+(1.006)+(2.010), (I-655)+(1.006)+(2.011), (I-655)+(1.006)+(2.012), (I-655)+(1.006)+(2.013), (I-655)+(1.006)+(2.014), (I-655)+(1.006)+(2.015), (I-655)+(1.006)+(2.016), (I-655)+(1.006)+(2.017), (I-655)+(1.006)+(2.018), (I-655)+(1.006)+(2.019), (I-655)+(1.006)+(2.020), (I-655)+(1.006)+(2.021), (I-655)+(1.006)+(2.022), (I-655)+(1.006)+(2.023), (I-655)+(1.006)+(2.024), (I-655)+(1.006)+(2.025), (I-655)+(1.006)+(2.026), (I-655)+(1.006)+(2.027), (I-655)+(1.006)+(2.028), (I-655)+(1.006)+(2.029), (I-655)+(1.006)+(2.030), (I-655)+(1.006)+(2.031), (I-655)+(1.006)+(2.032), (I-655)+(1.006)+(2.033), (I-655)+(1.006)+(2.034), (I-655)+(1.006)+(2.035), (I-655)+(1.006)+(2.036), (I-655)+(1.006)+(2.037), (I-655)+(1.006)+(2.038), (I-655)+(1.006)+(2.039), (I-655)+(1.006)+(2.040), (I-655)+(1.006)+(2.041), (I-655)+(1.006)+(2.042), (I-655)+(1.006)+(2.043), (I-655)+(1.006)+(2.044), (I-655)+(1.006)+(2.045), (I-655)+(1.006)+(2.046), (I-655)+(1.006)+(2.047), (I-655)+(1.006)+(2.048), (I-655)+(1.006)+(2.049), (I-655)+(1.006)+(2.050), (I-655)+(1.006)+(2.051), (I-655)+(1.006)+(2.052), (I-655)+(1.006)+(2.053), (I-655)+(1.006)+(2.054), (I-655)+(1.006)+(2.055), (I-655)+(1.006)+(2.056), (I-655)+(1.006)+(2.057), (I-655)+(1.006)+(2.058), (I-655)+(1.006)+(2.059), (I-655)+(1.006)+(3.001), (I-655)+(1.006)+(3.002), (I-655)+(1.006)+(3.003), (I-655)+(1.006)+(3.004), (I-655)+(1.006)+(3.005), (I-655)+(1.006)+(3.006), (I-655)+(1.006)+(3.007), (I-655)+(1.006)+(3.008), (I-655)+(1.006)+(3.009), (I-655)+(1.006)+(3.010), (I-655)+(1.006)+(3.011), (I-655)+(1.006)+(3.012), (I-655)+(1.006)+(3.013), (I-655)+(1.006)+(3.014), (I-655)+(1.006)+(3.015), (I-655)+(1.006)+(3.016), (I-655)+(1.006)+(3.017), (I-655)+(1.006)+(3.018), (I-655)+(1.006)+(3.019), (I-655)+(1.006)+(3.020), (I-655)+(1.006)+(3.021), (I-655)+(1.006)+(3.022), (I-655)+(1.006)+(3.023), (I-655)+(1.006)+(3.024), (I-655)+(1.006)+(3.025), (I-655)+(1.006)+(3.026), (I-655)+(1.006)+(3.027), (I-655)+(1.006)+(3.028), (I-655)+(1.006)+(3.029), (I-655)+(1.006)+(3.030), (I-655)+(1.006)+(3.031), (I-655)+(1.006)+(5.001), (I-655)+(1.006)+(5.002), (I-655)+(1.006)+(5.003), (I-655)+(1.006)+(5.004), (I-655)+(1.006)+(5.005), (I-655)+(1.006)+(5.006), (I-655)+(1.006)+(5.007), (I-655)+(1.006)+(5.008), (I-655)+(1.006)+(5.009), (I-655)+(1.006)+(5.010), (I-655)+(1.006)+(5.011), (I-655)+(1.006)+(5.012), (I-655)+(1.006)+(5.013), (I-655)+(1.006)+(5.014), (I-655)+(1.006)+(5.015), (I-655)+(1.006)+(5.016), (I-655)+(1.006)+(5.017), (I-655)+(1.006)+(5.018), (I-655)+(1.006)+(5.019), (I-655)+(1.006)+(5.020), (I-655)+(1.006)+(5.021), (I-655)+(1.006)+(5.022), (I-655)+(1.006)+(5.023), (I-655)+(1.006)+(6.001), (I-655)+(1.006)+(6.002), (I-655)+(1.006)+(6.003), (I-655)+(1.006)+(6.004), (I-655)+(1.006)+(7.001), (I-655)+(1.006)+(7.002), (I-655)+(1.006)+(7.003), (I-655)+(1.006)+(7.004), (I-655)+(1.006)+(7.005), (I-655)+(1.006)+(7.006), (I-655)+(1.006)+(9.001), (I-655)+(1.006)+(9.002), (I-655)+(1.006)+(9.003), (I-655)+(1.006)+(9.004), (I-655)+(1.006)+(9.005), (I-655)+(1.006)+(9.006), (I-655)+(1.006)+(9.007), (I-655)+(1.006)+(9.008), (I-655)+(1.006)+(9.009), (I-655)+(1.006)+(14.001), (I-655)+(1.006)+(14.002), (I-655)+(1.006)+(15.008), (I-655)+(1.006)+(15.011), (I-655)+(1.006)+(15.012), (I-655)+(1.006)+(15.016), (I-655)+(1.006)+(15.025), (I-655)+(1.006)+(15.027), (I-655)+(1.006)+(15.047), (I-655)+(1.006)+(15.063), (I-655)+(1.006)+(15.064), (I-655)+(1.006)+(16.001), (I-655)+(1.006)+(16.002), (I-655)+(1.006)+(16.003), (I-655)+(1.006)+(16.004), (I-655)+(1.006)+(16.005), (I-655)+(1.006)+(16.006), (I-655)+(1.006)+(16.007), (I-655)+(1.006)+(16.008), (I-655)+(1.006)+(17.001), (I-655)+(1.006)+(17.002), (I-655)+(1.006)+(17.003), (I-655)+(1.006)+(17.004), (I-655)+(1.006)+(17.005), (I-655)+(1.006)+(17.006), (I-655)+(1.006)+(17.007), (I-655)+(1.006)+(17.008), (I-655)+(1.006)+(17.009), (I-655)+(1.006)+(17.010), (I-655)+(1.006)+(17.011), (I-655)+(1.006)+(17.012), (I-655)+(1.006)+(18.001),

(I-655)+(1.007)+(1.008), (I-655)+(1.007)+(1.009), (I-655)+(1.007)+(1.010), (I-655)+(1.007)+(1.011), (I-655)+(1.007)+(1.012), (I-655)+(1.007)+(1.013), (I-655)+(1.007)+(1.014), (I-655)+(1.007)+(1.015), (I-655)+(1.007)+(1.016), (I-655)+(1.007)+(1.017), (I-655)+(1.007)+(1.018), (I-655)+(1.007)+(1.019), (I-655)+(1.007)+(1.020), (I-655)+(1.007)+(1.021), (I-655)+(1.007)+(1.022), (I-655)+(1.007)+(1.023), (I-655)+(1.007)+(1.024), (I-655)+(1.007)+(1.025), (I-655)+(1.007)+(1.026), (I-655)+(1.007)+(1.027), (I-655)+(1.007)+(1.028), (I-655)+(1.007)+(1.029), (I-655)+(1.007)+(1.030), (I-655)+(1.007)+(1.031), (I-655)+(1.007)+(1.032), (I-655)+(1.007)+(1.033), (I-655)+(1.007)+(1.034), (I-655)+(1.007)+(1.035), (I-655)+(1.007)+(1.036), (I-655)+(1.007)+(1.037), (I-655)+(1.007)+(1.038), (I-655)+(1.007)+(1.039), (I-655)+(1.007)+(1.040), (I-655)+(1.007)+(1.041), (I-655)+(1.007)+(1.042), (I-655)+(1.007)+(1.043), (I-655)+(1.007)+(1.044), (I-655)+(1.007)+(1.045), (I-655)+(1.007)+(1.046), (I-655)+(1.007)+(1.047), (I-655)+(1.007)+(1.048), (I-655)+(1.007)+(1.049), (I-655)+(1.007)+(1.050), (I-655)+(1.007)+(1.051), (I-655)+(1.007)+(1.052), (I-655)+(1.007)+(1.053), (I-655)+(1.007)+(1.054), (I-655)+(1.007)+(1.055), (I-655)+(1.007)+(1.056), (I-655)+(1.007)+(1.057), (I-655)+(1.007)+(1.058), (I-655)+(1.007)+(1.059), (I-655)+(1.007)+(1.060), (I-655)+(1.007)+(1.061), (I-655)+(1.007)+(1.062), (I-655)+(1.007)+(1.063), (I-655)+(1.007)+(1.064), (I-655)+(1.007)+(1.065), (I-655)+(1.007)+(1.066), (I-655)+(1.007)+(1.067), (I-655)+(1.007)+(1.068), (I-655)+(1.007)+(1.069), (I-655)+(1.007)+(1.070), (I-655)+(1.007)+(1.071), (I-655)+(1.007)+(1.072), (I-655)+(1.007)+(1.073), (I-655)+(1.007)+(1.074), (I-655)+(1.007)+(1.075), (I-655)+(1.007)+(1.076), (I-655)+(1.007)+(1.077), (I-655)+(1.007)+(1.078), (I-655)+(1.007)+(1.079), (I-655)+(1.007)+(1.080), (I-655)+(1.007)+(1.081), (I-655)+(1.007)+(1.082), (I-655)+(1.007)+(1.083), (I-655)+(1.007)+(1.084), (I-655)+(1.007)+(1.085), (I-655)+(1.007)+(1.086), (I-655)+(1.007)+(1.087), (I-655)+(1.007)+(1.088), (I-655)+(1.007)+(1.089), (I-655)+(1.007)+(1.090), (I-655)+(1.007)+(1.091), (I-655)+(1.007)+(1.092), (I-655)+(1.007)+(2.001), (I-655)+(1.007)+(2.002), (I-655)+(1.007)+(2.003), (I-655)+(1.007)+(2.004), (I-655)+(1.007)+(2.005), (I-655)+(1.007)+(2.006), (I-655)+(1.007)+(2.007), (I-655)+(1.007)+(2.008), (I-655)+(1.007)+(2.009), (I-655)+(1.007)+(2.010), (I-655)+(1.007)+(2.011), (I-655)+(1.007)+(2.012), (I-655)+(1.007)+(2.013), (I-655)+(1.007)+(2.014), (I-655)+(1.007)+(2.015), (I-655)+(1.007)+(2.016), (I-655)+(1.007)+(2.017), (I-655)+(1.007)+(2.018), (I-655)+(1.007)+(2.019), (I-655)+(1.007)+(2.020), (I-655)+(1.007)+(2.021), (I-655)+(1.007)+(2.022), (I-655)+(1.007)+(2.023), (I-655)+(1.007)+(2.024), (I-655)+(1.007)+(2.025), (I-655)+(1.007)+(2.026), (I-655)+(1.007)+(2.027), (I-655)+(1.007)+(2.028), (I-655)+(1.007)+(2.029), (I-655)+(1.007)+(2.030), (I-655)+(1.007)+(2.031), (I-655)+(1.007)+(2.032), (I-655)+(1.007)+(2.033), (I-655)+(1.007)+(2.034), (I-655)+(1.007)+(2.035), (I-655)+(1.007)+(2.036), (I-655)+(1.007)+(2.037), (I-655)+(1.007)+(2.038), (I-655)+(1.007)+(2.039), (I-655)+(1.007)+(2.040), (I-655)+(1.007)+(2.041), (I-655)+(1.007)+(2.042), (I-655)+(1.007)+(2.043), (I-655)+(1.007)+(2.044), (I-655)+(1.007)+(2.045), (I-655)+(1.007)+(2.046), (I-655)+(1.007)+(2.047), (I-655)+(1.007)+(2.048), (I-655)+(1.007)+(2.049), (I-655)+(1.007)+(2.050), (I-655)+(1.007)+(2.051), (I-655)+(1.007)+(2.052), (I-655)+(1.007)+(2.053), (I-655)+(1.007)+(2.054), (I-655)+(1.007)+(2.055), (I-655)+(1.007)+(2.056), (I-655)+(1.007)+(2.057), (I-655)+(1.007)+(2.058), (I-655)+(1.007)+(2.059), (I-655)+(1.007)+(3.001), (I-655)+(1.007)+(3.002), (I-655)+(1.007)+(3.003), (I-655)+(1.007)+(3.004), (I-655)+(1.007)+(3.005), (I-655)+(1.007)+(3.006), (I-655)+(1.007)+(3.007), (I-655)+(1.007)+(3.008), (I-655)+(1.007)+(3.009), (I-655)+(1.007)+(3.010), (I-655)+(1.007)+(3.011), (I-655)+(1.007)+(3.012), (I-655)+(1.007)+(3.013), (I-655)+(1.007)+(3.014), (I-655)+(1.007)+(3.015), (I-655)+(1.007)+(3.016), (I-655)+(1.007)+(3.017), (I-655)+(1.007)+(3.018), (I-655)+(1.007)+(3.019), (I-655)+(1.007)+(3.020), (I-655)+(1.007)+(3.021), (I-655)+(1.007)+(3.022), (I-655)+(1.007)+(3.023), (I-655)+(1.007)+(3.024), (I-655)+(1.007)+(3.025), (I-655)+(1.007)+(3.026), (I-655)+(1.007)+(3.027), (I-655)+(1.007)+(3.028), (I-655)+(1.007)+(3.029), (I-655)+(1.007)+(3.030), (I-655)+(1.007)+(3.031), (I-655)+(1.007)+(5.001), (I-655)+(1.007)+(5.002), (I-655)+(1.007)+(5.003), (I-655)+(1.007)+(5.004), (I-655)+(1.007)+(5.005), (I-655)+(1.007)+(5.006), (I-655)+(1.007)+(5.007), (I-655)+(1.007)+(5.008), (I-655)+(1.007)+(5.009), (I-655)+(1.007)+(5.010), (I-655)+(1.007)+(5.011), (I-655)+(1.007)+(5.012), (I-655)+(1.007)+(5.013), (I-655)+(1.007)+(5.014), (I-655)+(1.007)+(5.015), (I-655)+(1.007)+(5.016), (I-655)+(1.007)+(5.017), (I-655)+(1.007)+(5.018), (I-655)+(1.007)+(5.019), (I-655)+(1.007)+(5.020), (I-655)+(1.007)+(5.021), (I-655)+(1.007)+(5.022), (I-655)+(1.007)+(5.023), (I-655)+(1.007)+(6.001), (I-655)+(1.007)+(6.002), (I-655)+(1.007)+(6.003), (I-655)+(1.007)+(6.004), (I-655)+(1.007)+(7.001), (I-655)+(1.007)+(7.002), (I-655)+(1.007)+(7.003), (I-655)+(1.007)+(7.004), (I-655)+(1.007)+(7.005), (I-655)+(1.007)+(7.006), (I-655)+(1.007)+(9.001), (I-655)+(1.007)+(9.002), (I-655)+(1.007)+(9.003), (I-655)+(1.007)+(9.004), (I-655)+(1.007)+(9.005), (I-655)+(1.007)+(9.006), (I-655)+(1.007)+(9.007), (I-655)+(1.007)+(9.008), (I-655)+(1.007)+(9.009), (I-655)+(1.007)+(14.001), (I-655)+(1.007)+(14.002), (I-655)+(1.007)+(15.008), (I-655)+(1.007)+(15.011), (I-655)+(1.007)+(15.012), (I-655)+(1.007)+(15.016), (I-655)+(1.007)+(15.025), (I-655)+(1.007)+(15.027), (I-655)+(1.007)+(15.047), (I-655)+(1.007)+(15.063), (I-655)+(1.007)+(15.064), (I-655)+(1.007)+(16.001), (I-655)+(1.007)+(16.002), (I-655)+(1.007)+(16.003), (I-655)+(1.007)+(16.004), (I-655)+(1.007)+(16.005), (I-655)+(1.007)+(16.006), (I-655)+(1.007)+(16.007), (I-655)+(1.007)+(16.008), (I-655)+(1.007)+(17.001), (I-655)+(1.007)+(17.002), (I-655)+(1.007)+(17.003), (I-655)+(1.007)+(17.004), (I-655)+(1.007)+(17.005), (I-655)+(1.007)+(17.006), (I-655)+(1.007)+(17.007), (I-655)+(1.007)+(17.008), (I-655)+(1.007)+(17.009), (I-655)+(1.007)+(17.010), (I-655)+(1.007)+(17.011), (I-655)+(1.007)+(17.012), (I-655)+(1.007)+(18.001),

(I-655)+(1.008)+(1.009), (I-655)+(1.008)+(1.010), (I-655)+(1.008)+(1.011), (I-655)+(1.008)+(1.012), (I-655)+(1.008)+(1.013), (I-655)+(1.008)+(1.014), (I-655)+(1.008)+(1.015), (I-655)+(1.008)+(1.016), (I-655)+(1.008)+(1.017), (I-655)+(1.008)+(1.018), (I-655)+(1.008)+(1.019), (I-655)+(1.008)+(1.020), (I-655)+(1.008)+(1.021), (I-655)+(1.008)+(1.022), (I-655)+(1.008)+(1.023), (I-655)+(1.008)+(1.024), (I-655)+(1.008)+(1.025), (I-655)+(1.008)+(1.026), (I-655)+(1.008)+(1.027), (I-655)+(1.008)+(1.028), (I-655)+(1.008)+(1.029), (I-655)+(1.008)+(1.030), (I-655)+(1.008)+(1.031), (I-655)+(1.008)+(1.032), (I-655)+(1.008)+(1.033), (I-655)+(1.008)+(1.034), (I-655)+(1.008)+(1.035), (I-655)+(1.008)+(1.036), (I-655)+(1.008)+(1.037), (I-655)+(1.008)+(1.038), (I-655)+(1.008)+(1.039), (I-655)+(1.008)+(1.040), (I-655)+(1.008)+(1.041), (I-655)+(1.008)+(1.042), (I-655)+(1.008)+(1.043), (I-655)+(1.008)+(1.044), (I-655)+(1.008)+(1.045), (I-655)+(1.008)+(1.046), (I-655)+(1.008)+(1.047), (I-655)+(1.008)+(1.048), (I-655)+(1.008)+(1.049), (I-655)+(1.008)+(1.050), (I-655)+(1.008)+(1.051), (I-655)+(1.008)+(1.052), (I-655)+(1.008)+(1.053), (I-655)+(1.008)+(1.054), (I-655)+(1.008)+(1.055), (I-655)+(1.008)+(1.056), (I-655)+(1.008)+(1.057), (I-655)+(1.008)+(1.058), (I-655)+(1.008)+(1.059), (I-655)+(1.008)+(1.060), (I-655)+(1.008)+(1.061), (I-655)+(1.008)+(1.062), (I-655)+(1.008)+(1.063), (I-655)+(1.008)+(1.064), (I-655)+(1.008)+(1.065), (I-655)+(1.008)+(1.066), (I-655)+(1.008)+(1.067), (I-655)+(1.008)+(1.068), (I-655)+(1.008)+(1.069), (I-655)+(1.008)+(1.070), (I-655)+(1.008)+(1.071), (I-655)+(1.008)+(1.072), (I-655)+(1.008)+(1.073), (I-655)+(1.008)+(1.074), (I-655)+(1.008)+(1.075), (I-655)+(1.008)+(1.076), (I-655)+(1.008)+(1.077), (I-655)+(1.008)+(1.078), (I-655)+(1.008)+(1.079), (I-655)+(1.008)+(1.080), (I-655)+(1.008)+(1.081), (I-655)+(1.008)+(1.082), (I-655)+(1.008)+(1.083), (I-655)+(1.008)+(1.084), (I-655)+(1.008)+(1.085), (I-655)+(1.008)+(1.086), (I-655)+(1.008)+(1.087), (I-655)+(1.008)+(1.088), (I-655)+(1.008)+(1.089), (I-655)+(1.008)+(1.090), (I-655)+(1.008)+(1.091), (I-655)+(1.008)+(1.092), (I-655)+(1.008)+(2.001), (I-655)+(1.008)+(2.002), (I-655)+(1.008)+(2.003), (I-655)+(1.008)+(2.004), (I-655)+(1.008)+(2.005), (I-655)+(1.008)+(2.006), (I-655)+(1.008)+(2.007), (I-655)+(1.008)+(2.008), (I-655)+(1.008)+(2.009), (I-655)+(1.008)+(2.010), (I-655)+(1.008)+(2.011), (I-655)+(1.008)+(2.012), (I-655)+(1.008)+(2.013), (I-655)+(1.008)+(2.014), (I-655)+(1.008)+(2.015), (I-655)+(1.008)+(2.016), (I-655)+(1.008)+(2.017), (I-655)+(1.008)+(2.018), (I-655)+(1.008)+(2.019), (I-655)+(1.008)+(2.020), (I-655)+(1.008)+(2.021), (I-655)+(1.008)+(2.022), (I-655)+(1.008)+(2.023), (I-655)+(1.008)+(2.024), (I-655)+(1.008)+(2.025), (I-655)+(1.008)+(2.026), (I-655)+(1.008)+(2.027), (I-655)+(1.008)+(2.028), (I-655)+(1.008)+(2.029), (I-655)+(1.008)+(2.030), (I-655)+(1.008)+(2.031), (I-655)+(1.008)+(2.032), (I-655)+(1.008)+(2.033), (I-655)+(1.008)+(2.034), (I-655)+(1.008)+(2.035), (I-655)+(1.008)+(2.036), (I-655)+(1.008)+(2.037), (I-655)+(1.008)+(2.038), (I-655)+(1.008)+(2.039), (I-655)+(1.008)+(2.040), (I-655)+(1.008)+(2.041), (I-655)+(1.008)+(2.042), (I-655)+(1.008)+(2.043), (I-655)+(1.008)+(2.044), (I-655)+(1.008)+(2.045), (I-655)+(1.008)+(2.046), (I-655)+(1.008)+(2.047), (I-655)+(1.008)+(2.048), (I-655)+(1.008)+(2.049), (I-655)+(1.008)+(2.050), (I-655)+(1.008)+(2.051), (I-655)+(1.008)+(2.052), (I-655)+(1.008)+(2.053), (I-655)+(1.008)+(2.054), (I-655)+(1.008)+(2.055), (I-655)+(1.008)+(2.056), (I-655)+(1.008)+(2.057), (I-655)+(1.008)+(2.058), (I-655)+(1.008)+(2.059), (I-655)+(1.008)+(3.001), (I-655)+(1.008)+(3.002), (I-655)+(1.008)+(3.003), (I-655)+(1.008)+(3.004), (I-655)+(1.008)+(3.005), (I-655)+(1.008)+(3.006), (I-655)+(1.008)+(3.007), (I-655)+(1.008)+(3.008), (I-655)+(1.008)+(3.009), (I-655)+(1.008)+(3.010), (I-655)+(1.008)+(3.011), (I-655)+(1.008)+(3.012), (I-655)+(1.008)+(3.013), (I-655)+(1.008)+(3.014), (I-655)+(1.008)+(3.015), (I-655)+(1.008)+(3.016), (I-655)+(1.008)+(3.017), (I-655)+(1.008)+(3.018), (I-655)+(1.008)+(3.019), (I-655)+(1.008)+(3.020), (I-655)+(1.008)+(3.021), (I-655)+(1.008)+(3.022), (I-655)+(1.008)+(3.023), (I-655)+(1.008)+(3.024), (I-655)+(1.008)+(3.025), (I-655)+(1.008)+(3.026), (I-655)+(1.008)+(3.027), (I-655)+(1.008)+(3.028), (I-655)+(1.008)+(3.029), (I-655)+(1.008)+(3.030), (I-655)+(1.008)+(3.031), (I-655)+(1.008)+(5.001), (I-655)+(1.008)+(5.002), (I-655)+(1.008)+(5.003), (I-655)+(1.008)+(5.004), (I-655)+(1.008)+(5.005), (I-655)+(1.008)+(5.006), (I-655)+(1.008)+(5.007), (I-655)+(1.008)+(5.008), (I-655)+(1.008)+(5.009), (I-655)+(1.008)+(5.010), (I-655)+(1.008)+(5.011), (I-655)+(1.008)+(5.012), (I-655)+(1.008)+(5.013), (I-655)+(1.008)+(5.014), (I-655)+(1.008)+(5.015), (I-655)+(1.008)+(5.016), (I-655)+(1.008)+(5.017), (I-655)+(1.008)+(5.018), (I-655)+(1.008)+(5.019), (I-655)+(1.008)+(5.020), (I-655)+(1.008)+(5.021), (I-655)+(1.008)+(5.022), (I-655)+(1.008)+(5.023), (I-655)+(1.008)+(6.001), (I-655)+(1.008)+(6.002), (I-655)+(1.008)+(6.003), (I-655)+(1.008)+(6.004), (I-655)+(1.008)+(7.001), (I-655)+(1.008)+(7.002), (I-655)+(1.008)+(7.003), (I-655)+(1.008)+(7.004), (I-655)+(1.008)+(7.005), (I-655)+(1.008)+(7.006), (I-655)+(1.008)+(9.001), (I-655)+(1.008)+(9.002), (I-655)+(1.008)+(9.003), (I-655)+(1.008)+(9.004), (I-655)+(1.008)+(9.005), (I-655)+(1.008)+(9.006), (I-655)+(1.008)+(9.007), (I-655)+(1.008)+(9.008), (I-655)+(1.008)+(9.009), (I-655)+(1.008)+(14.001), (I-655)+(1.008)+(14.002), (I-655)+(1.008)+(15.008), (I-655)+(1.008)+(15.011), (I-655)+(1.008)+(15.012), (I-655)+(1.008)+(15.016), (I-655)+(1.008)+(15.025), (I-655)+(1.008)+(15.027), (I-655)+(1.008)+(15.047), (I-655)+(1.008)+(15.063), (I-655)+(1.008)+(15.064), (I-655)+(1.008)+(16.001), (I-655)+(1.008)+(16.002), (I-655)+(1.008)+(16.003), (I-655)+(1.008)+(16.004), (I-655)+(1.008)+(16.005), (I-655)+(1.008)+(16.006), (I-655)+(1.008)+(16.007), (I-655)+(1.008)+(16.008), (I-655)+(1.008)+(17.001), (I-655)+(1.008)+(17.002), (I-655)+(1.008)+(17.003), (I-655)+(1.008)+(17.004), (I-655)+(1.008)+(17.005), (I-655)+(1.008)+(17.006), (I-655)+(1.008)+(17.007), (I-655)+(1.008)+(17.008), (I-655)+(1.008)+(17.009), (I-655)+(1.008)+(17.010), (I-655)+(1.008)+(17.011), (I-655)+(1.008)+(17.012), (I-655)+(1.008)+(18.001),

(I-655)+(1.009)+(1.010), (I-655)+(1.009)+(1.011), (I-655)+(1.009)+(1.012), (I-655)+(1.009)+(1.013), (I-655)+(1.009)+(1.014), (I-655)+(1.009)+(1.015), (I-655)+(1.009)+(1.016), (I-655)+(1.009)+(1.017), (I-655)+(1.009)+(1.018), (I-655)+(1.009)+(1.019), (I-655)+(1.009)+(1.020), (I-655)+(1.009)+(1.021), (I-655)+(1.009)+(1.022), (I-655)+(1.009)+(1.023), (I-655)+(1.009)+(1.024), (I-655)+(1.009)+(1.025), (I-655)+(1.009)+(1.026), (I-655)+(1.009)+(1.027), (I-655)+(1.009)+(1.028), (I-655)+(1.009)+(1.029), (I-655)+(1.009)+(1.030), (I-655)+(1.009)+(1.031), (I-655)+(1.009)+(1.032), (I-655)+(1.009)+(1.033), (I-655)+(1.009)+(1.034), (I-655)+(1.009)+(1.035), (I-655)+(1.009)+(1.036), (I-655)+(1.009)+(1.037), (I-655)+(1.009)+(1.038), (I-655)+(1.009)+(1.039), (I-655)+(1.009)+(1.040), (I-655)+(1.009)+(1.041), (I-655)+(1.009)+(1.042), (I-655)+(1.009)+(1.043), (I-655)+(1.009)+(1.044), (I-655)+(1.009)+(1.045), (I-655)+(1.009)+(1.046), (I-655)+(1.009)+(1.047), (I-655)+(1.009)+(1.048), (I-655)+(1.009)+(1.049), (I-655)+(1.009)+(1.050), (I-655)+(1.009)+(1.051), (I-655)+(1.009)+(1.052), (I-655)+(1.009)+(1.053), (I-655)+(1.009)+(1.054), (I-655)+(1.009)+(1.055), (I-655)+(1.009)+(1.056), (I-655)+(1.009)+(1.057), (I-655)+(1.009)+(1.058), (I-655)+(1.009)+(1.059), (I-655)+(1.009)+(1.060), (I-655)+(1.009)+(1.061), (I-655)+(1.009)+(1.062), (I-655)+(1.009)+(1.063), (I-655)+(1.009)+(1.064), (I-655)+(1.009)+(1.065), (I-655)+(1.009)+(1.066), (I-655)+(1.009)+(1.067), (I-655)+(1.009)+(1.068), (I-655)+(1.009)+(1.069), (I-655)+(1.009)+(1.070), (I-655)+(1.009)+(1.071), (I-655)+(1.009)+(1.072), (I-655)+(1.009)+(1.073), (I-655)+(1.009)+(1.074), (I-655)+(1.009)+(1.075), (I-655)+(1.009)+(1.076), (I-655)+(1.009)+(1.077), (I-655)+(1.009)+(1.078), (I-655)+(1.009)+(1.079), (I-655)+(1.009)+(1.080), (I-655)+(1.009)+(1.081), (I-655)+(1.009)+(1.082), (I-655)+(1.009)+(1.083), (I-655)+(1.009)+(1.084), (I-655)+(1.009)+(1.085), (I-655)+(1.009)+(1.086), (I-655)+(1.009)+(1.087), (I-655)+(1.009)+(1.088), (I-655)+(1.009)+(1.089), (I-655)+(1.009)+(1.090), (I-655)+(1.009)+(1.091), (I-655)+(1.009)+(1.092), (I-655)+(1.009)+(2.001), (I-655)+(1.009)+(2.002), (I-655)+(1.009)+(2.003), (I-655)+(1.009)+(2.004), (I-655)+(1.009)+(2.005), (I-655)+(1.009)+(2.006), (I-655)+(1.009)+(2.007), (I-655)+(1.009)+(2.008), (I-655)+(1.009)+(2.009), (I-655)+(1.009)+(2.010), (I-655)+(1.009)+(2.011), (I-655)+(1.009)+(2.012), (I-655)+(1.009)+(2.013), (I-655)+(1.009)+(2.014), (I-655)+(1.009)+(2.015), (I-655)+(1.009)+(2.016), (I-655)+(1.009)+(2.017), (I-655)+(1.009)+(2.018), (I-655)+(1.009)+(2.019), (I-655)+(1.009)+(2.020), (I-655)+(1.009)+(2.021), (I-655)+(1.009)+(2.022), (I-655)+(1.009)+(2.023), (I-655)+(1.009)+(2.024), (I-655)+(1.009)+(2.025), (I-655)+(1.009)+(2.026), (I-655)+(1.009)+(2.027), (I-655)+(1.009)+(2.028), (I-655)+(1.009)+(2.029), (I-655)+(1.009)+(2.030), (I-655)+(1.009)+(2.031), (I-655)+(1.009)+(2.032), (I-655)+(1.009)+(2.033), (I-655)+(1.009)+(2.034), (I-655)+(1.009)+(2.035), (I-655)+(1.009)+(2.036), (I-655)+(1.009)+(2.037), (I-655)+(1.009)+(2.038), (I-655)+(1.009)+(2.039), (I-655)+(1.009)+(2.040), (I-655)+(1.009)+(2.041), (I-655)+(1.009)+(2.042), (I-655)+(1.009)+(2.043), (I-655)+(1.009)+(2.044), (I-655)+(1.009)+(2.045), (I-655)+(1.009)+(2.046), (I-655)+(1.009)+(2.047), (I-655)+(1.009)+(2.048), (I-655)+(1.009)+(2.049), (I-655)+(1.009)+(2.050), (I-655)+(1.009)+(2.051), (I-655)+(1.009)+(2.052), (I-655)+(1.009)+(2.053), (I-655)+(1.009)+(2.054), (I-655)+(1.009)+(2.055), (I-655)+(1.009)+(2.056), (I-655)+(1.009)+(2.057), (I-655)+(1.009)+(2.058), (I-655)+(1.009)+(2.059), (I-655)+(1.009)+(3.001), (I-655)+(1.009)+(3.002), (I-655)+(1.009)+(3.003), (I-655)+(1.009)+(3.004), (I-655)+(1.009)+(3.005), (I-655)+(1.009)+(3.006), (I-655)+(1.009)+(3.007), (I-655)+(1.009)+(3.008), (I-655)+(1.009)+(3.009), (I-655)+(1.009)+(3.010), (I-655)+(1.009)+(3.011), (I-655)+(1.009)+(3.012), (I-655)+(1.009)+(3.013), (I-655)+(1.009)+(3.014), (I-655)+(1.009)+(3.015), (I-655)+(1.009)+(3.016), (I-655)+(1.009)+(3.017), (I-655)+(1.009)+(3.018), (I-655)+(1.009)+(3.019), (I-655)+(1.009)+(3.020), (I-655)+(1.009)+(3.021), (I-655)+(1.009)+(3.022), (I-655)+(1.009)+(3.023), (I-655)+(1.009)+(3.024), (I-655)+(1.009)+(3.025), (I-655)+(1.009)+(3.026), (I-655)+(1.009)+(3.027), (I-655)+(1.009)+(3.028), (I-655)+(1.009)+(3.029), (I-655)+(1.009)+(3.030), (I-655)+(1.009)+(3.031), (I-655)+(1.009)+(5.001), (I-655)+(1.009)+(5.002), (I-655)+(1.009)+(5.003), (I-655)+(1.009)+(5.004), (I-655)+(1.009)+(5.005), (I-655)+(1.009)+(5.006), (I-655)+(1.009)+(5.007), (I-655)+(1.009)+(5.008), (I-655)+(1.009)+(5.009), (I-655)+(1.009)+(5.010), (I-655)+(1.009)+(5.011), (I-655)+(1.009)+(5.012), (I-655)+(1.009)+(5.013), (I-655)+(1.009)+(5.014), (I-655)+(1.009)+(5.015), (I-655)+(1.009)+(5.016), (I-655)+(1.009)+(5.017), (I-655)+(1.009)+(5.018), (I-655)+(1.009)+(5.019), (I-655)+(1.009)+(5.020), (I-655)+(1.009)+(5.021), (I-655)+(1.009)+(5.022), (I-655)+(1.009)+(5.023), (I-655)+(1.009)+(6.001), (I-655)+(1.009)+(6.002), (I-655)+(1.009)+(6.003), (I-655)+(1.009)+(6.004), (I-655)+(1.009)+(7.001), (I-655)+(1.009)+(7.002), (I-655)+(1.009)+(7.003), (I-655)+(1.009)+(7.004), (I-655)+(1.009)+(7.005), (I-655)+(1.009)+(7.006), (I-655)+(1.009)+(9.001), (I-655)+(1.009)+(9.002), (I-655)+(1.009)+(9.003), (I-655)+(1.009)+(9.004), (I-655)+(1.009)+(9.005), (I-655)+(1.009)+(9.006), (I-655)+(1.009)+(9.007), (I-655)+(1.009)+(9.008), (I-655)+(1.009)+(9.009), (I-655)+(1.009)+(14.001), (I-655)+(1.009)+(14.002), (I-655)+(1.009)+(15.008), (I-655)+(1.009)+(15.011), (I-655)+(1.009)+(15.012), (I-655)+(1.009)+(15.016), (I-655)+(1.009)+(15.025), (I-655)+(1.009)+(15.027), (I-655)+(1.009)+(15.047), (I-655)+(1.009)+(15.063), (I-655)+(1.009)+(15.064), (I-655)+(1.009)+(16.001), (I-655)+(1.009)+(16.002), (I-655)+(1.009)+(16.003), (I-655)+(1.009)+(16.004), (I-655)+(1.009)+(16.005), (I-655)+(1.009)+(16.006), (I-655)+(1.009)+(16.007), (I-655)+(1.009)+(16.008), (I-655)+(1.009)+(17.001), (I-655)+(1.009)+(17.002), (I-655)+(1.009)+(17.003), (I-655)+(1.009)+(17.004), (I-655)+(1.009)+(17.005), (I-655)+(1.009)+(17.006), (I-655)+(1.009)+(17.007), (I-655)+(1.009)+(17.008), (I-655)+(1.009)+(17.009), (I-655)+(1.009)+(17.010), (I-655)+(1.009)+(17.011), (I-655)+(1.009)+(17.012), (I-655)+(1.009)+(18.001),

(I-655)+(1.010)+(1.011), (I-655)+(1.010)+(1.012), (I-655)+(1.010)+(1.013), (I-655)+(1.010)+(1.014), (I-655)+(1.010)+(1.015), (I-655)+(1.010)+(1.016), (I-655)+(1.010)+(1.017), (I-655)+(1.010)+(1.018), (I-655)+(1.010)+(1.019), (I-655)+(1.010)+(1.020), (I-655)+(1.010)+(1.021), (I-655)+(1.010)+(1.022), (I-655)+(1.010)+(1.023), (I-655)+(1.010)+(1.024), (I-655)+(1.010)+(1.025), (I-655)+(1.010)+(1.026), (I-655)+(1.010)+(1.027), (I-655)+(1.010)+(1.028), (I-655)+(1.010)+(1.029), (I-655)+(1.010)+(1.030), (I-655)+(1.010)+(1.031), (I-655)+(1.010)+(1.032), (I-655)+(1.010)+(1.033), (I-655)+(1.010)+(1.034), (I-655)+(1.010)+(1.035), (I-655)+(1.010)+(1.036), (I-655)+(1.010)+(1.037), (I-655)+(1.010)+(1.038), (I-655)+(1.010)+(1.039), (I-655)+(1.010)+(1.040), (I-655)+(1.010)+(1.041), (I-655)+(1.010)+(1.042), (I-655)+(1.010)+(1.043), (I-655)+(1.010)+(1.044), (I-655)+(1.010)+(1.045), (I-655)+(1.010)+(1.046), (I-655)+(1.010)+(1.047), (I-655)+(1.010)+(1.048), (I-655)+(1.010)+(1.049), (I-655)+(1.010)+(1.050), (I-655)+(1.010)+(1.051), (I-655)+(1.010)+(1.052), (I-655)+(1.010)+(1.053), (I-655)+(1.010)+(1.054), (I-655)+(1.010)+(1.055), (I-655)+(1.010)+(1.056), (I-655)+(1.010)+(1.057), (I-655)+(1.010)+(1.058), (I-655)+(1.010)+(1.059), (I-655)+(1.010)+(1.060), (I-655)+(1.010)+(1.061), (I-655)+(1.010)+(1.062), (I-655)+(1.010)+(1.063), (I-655)+(1.010)+(1.064), (I-655)+(1.010)+(1.065), (I-655)+(1.010)+(1.066), (I-655)+(1.010)+(1.067), (I-655)+(1.010)+(1.068), (I-655)+(1.010)+(1.069), (I-655)+(1.010)+(1.070), (I-655)+(1.010)+(1.071), (I-655)+(1.010)+(1.072), (I-655)+(1.010)+(1.073), (I-655)+(1.010)+(1.074), (I-655)+(1.010)+(1.075), (I-655)+(1.010)+(1.076), (I-655)+(1.010)+(1.077), (I-655)+(1.010)+(1.078), (I-655)+(1.010)+(1.079), (I-655)+(1.010)+(1.080), (I-655)+(1.010)+(1.081), (I-655)+(1.010)+(1.082), (I-655)+(1.010)+(1.083), (I-655)+(1.010)+(1.084), (I-655)+(1.010)+(1.085), (I-655)+(1.010)+(1.086), (I-655)+(1.010)+(1.087), (I-655)+(1.010)+(1.088), (I-655)+(1.010)+(1.089), (I-655)+(1.010)+(1.090), (I-655)+(1.010)+(1.091), (I-655)+(1.010)+(1.092), (I-655)+(1.010)+(2.001), (I-655)+(1.010)+(2.002), (I-655)+(1.010)+(2.003), (I-655)+(1.010)+(2.004), (I-655)+(1.010)+(2.005), (I-655)+(1.010)+(2.006), (I-655)+(1.010)+(2.007), (I-655)+(1.010)+(2.008), (I-655)+(1.010)+(2.009), (I-655)+(1.010)+(2.010), (I-655)+(1.010)+(2.011), (I-655)+(1.010)+(2.012), (I-655)+(1.010)+(2.013), (I-655)+(1.010)+(2.014), (I-655)+(1.010)+(2.015), (I-655)+(1.010)+(2.016), (I-655)+(1.010)+(2.017), (I-655)+(1.010)+(2.018), (I-655)+(1.010)+(2.019), (I-655)+(1.010)+(2.020), (I-655)+(1.010)+(2.021), (I-655)+(1.010)+(2.022), (I-655)+(1.010)+(2.023), (I-655)+(1.010)+(2.024), (I-655)+(1.010)+(2.025), (I-655)+(1.010)+(2.026), (I-655)+(1.010)+(2.027), (I-655)+(1.010)+(2.028), (I-655)+(1.010)+(2.029), (I-655)+(1.010)+(2.030), (I-655)+(1.010)+(2.031), (I-655)+(1.010)+(2.032), (I-655)+(1.010)+(2.033), (I-655)+(1.010)+(2.034), (I-655)+(1.010)+(2.035), (I-655)+(1.010)+(2.036), (I-655)+(1.010)+(2.037), (I-655)+(1.010)+(2.038), (I-655)+(1.010)+(2.039), (I-655)+(1.010)+(2.040), (I-655)+(1.010)+(2.041), (I-655)+(1.010)+(2.042), (I-655)+(1.010)+(2.043), (I-655)+(1.010)+(2.044), (I-655)+(1.010)+(2.045), (I-655)+(1.010)+(2.046), (I-655)+(1.010)+(2.047), (I-655)+(1.010)+(2.048), (I-655)+(1.010)+(2.049), (I-655)+(1.010)+(2.050), (I-655)+(1.010)+(2.051), (I-655)+(1.010)+(2.052), (I-655)+(1.010)+(2.053), (I-655)+(1.010)+(2.054), (I-655)+(1.010)+(2.055), (I-655)+(1.010)+(2.056), (I-655)+(1.010)+(2.057), (I-655)+(1.010)+(2.058), (I-655)+(1.010)+(2.059), (I-655)+(1.010)+(3.001), (I-655)+(1.010)+(3.002), (I-655)+(1.010)+(3.003), (I-655)+(1.010)+(3.004), (I-655)+(1.010)+(3.005), (I-655)+(1.010)+(3.006), (I-655)+(1.010)+(3.007), (I-655)+(1.010)+(3.008), (I-655)+(1.010)+(3.009), (I-655)+(1.010)+(3.010), (I-655)+(1.010)+(3.011), (I-655)+(1.010)+(3.012), (I-655)+(1.010)+(3.013), (I-655)+(1.010)+(3.014), (I-655)+(1.010)+(3.015), (I-655)+(1.010)+(3.016), (I-655)+(1.010)+(3.017), (I-655)+(1.010)+(3.018), (I-655)+(1.010)+(3.019), (I-655)+(1.010)+(3.020), (I-655)+(1.010)+(3.021), (I-655)+(1.010)+(3.022), (I-655)+(1.010)+(3.023), (I-655)+(1.010)+(3.024), (I-655)+(1.010)+(3.025), (I-655)+(1.010)+(3.026), (I-655)+(1.010)+(3.027), (I-655)+(1.010)+(3.028), (I-655)+(1.010)+(3.029), (I-655)+(1.010)+(3.030), (I-655)+(1.010)+(3.031), (I-655)+(1.010)+(5.001), (I-655)+(1.010)+(5.002), (I-655)+(1.010)+(5.003), (I-655)+(1.010)+(5.004), (I-655)+(1.010)+(5.005), (I-655)+(1.010)+(5.006), (I-655)+(1.010)+(5.007), (I-655)+(1.010)+(5.008), (I-655)+(1.010)+(5.009), (I-655)+(1.010)+(5.010), (I-655)+(1.010)+(5.011), (I-655)+(1.010)+(5.012), (I-655)+(1.010)+(5.013), (I-655)+(1.010)+(5.014), (I-655)+(1.010)+(5.015), (I-655)+(1.010)+(5.016), (I-655)+(1.010)+(5.017), (I-655)+(1.010)+(5.018), (I-655)+(1.010)+(5.019), (I-655)+(1.010)+(5.020), (I-655)+(1.010)+(5.021), (I-655)+(1.010)+(5.022), (I-655)+(1.010)+(5.023), (I-655)+(1.010)+(6.001), (I-655)+(1.010)+(6.002), (I-655)+(1.010)+(6.003), (I-655)+(1.010)+(6.004), (I-655)+(1.010)+(7.001), (I-655)+(1.010)+(7.002), (I-655)+(1.010)+(7.003), (I-655)+(1.010)+(7.004), (I-655)+(1.010)+(7.005), (I-655)+(1.010)+(7.006), (I-655)+(1.010)+(9.001), (I-655)+(1.010)+(9.002), (I-655)+(1.010)+(9.003), (I-655)+(1.010)+(9.004), (I-655)+(1.010)+(9.005), (I-655)+(1.010)+(9.006), (I-655)+(1.010)+(9.007), (I-655)+(1.010)+(9.008), (I-655)+(1.010)+(9.009), (I-655)+(1.010)+(14.001), (I-655)+(1.010)+(14.002), (I-655)+(1.010)+(15.008), (I-655)+(1.010)+(15.011), (I-655)+(1.010)+(15.012), (I-655)+(1.010)+(15.016), (I-655)+(1.010)+(15.025), (I-655)+(1.010)+(15.027), (I-655)+(1.010)+(15.047), (I-655)+(1.010)+(15.063), (I-655)+(1.010)+(15.064), (I-655)+(1.010)+(16.001), (I-655)+(1.010)+(16.002), (I-655)+(1.010)+(16.003), (I-655)+(1.010)+(16.004), (I-655)+(1.010)+(16.005), (I-655)+(1.010)+(16.006), (I-655)+(1.010)+(16.007), (I-655)+(1.010)+(16.008), (I-655)+(1.010)+(17.001), (I-655)+(1.010)+(17.002), (I-655)+(1.010)+(17.003), (I-655)+(1.010)+(17.004), (I-655)+(1.010)+(17.005), (I-655)+(1.010)+(17.006), (I-655)+(1.010)+(17.007), (I-655)+(1.010)+(17.008), (I-655)+(1.010)+(17.009), (I-655)+(1.010)+(17.010), (I-655)+(1.010)+(17.011), (I-655)+(1.010)+(17.012), (I-655)+(1.010)+(18.001),

(I-655)+(1.011)+(1.012), (I-655)+(1.011)+(1.013), (I-655)+(1.011)+(1.014), (I-655)+(1.011)+(1.015), (I-655)+(1.011)+(1.016), (I-655)+(1.011)+(1.017), (I-655)+(1.011)+(1.018), (I-655)+(1.011)+(1.019), (I-655)+(1.011)+(1.020), (I-655)+(1.011)+(1.021), (I-655)+(1.011)+(1.022), (I-655)+(1.011)+(1.023), (I-655)+(1.011)+(1.024), (I-655)+(1.011)+(1.025), (I-655)+(1.011)+(1.026), (I-655)+(1.011)+(1.027), (I-655)+(1.011)+(1.028), (I-655)+(1.011)+(1.029), (I-655)+(1.011)+(1.030), (I-655)+(1.011)+(1.031), (I-655)+(1.011)+(1.032), (I-655)+(1.011)+(1.033), (I-655)+(1.011)+(1.034), (I-655)+(1.011)+(1.035), (I-655)+(1.011)+(1.036), (I-655)+(1.011)+(1.037), (I-655)+(1.011)+(1.038), (I-655)+(1.011)+(1.039), (I-655)+(1.011)+(1.040), (I-655)+(1.011)+(1.041), (I-655)+(1.011)+(1.042), (I-655)+(1.011)+(1.043), (I-655)+(1.011)+(1.044), (I-655)+(1.011)+(1.045), (I-655)+(1.011)+(1.046), (I-655)+(1.011)+(1.047), (I-655)+(1.011)+(1.048), (I-655)+(1.011)+(1.049), (I-655)+(1.011)+(1.050), (I-655)+(1.011)+(1.051), (I-655)+(1.011)+(1.052), (I-655)+(1.011)+(1.053), (I-655)+(1.011)+(1.054), (I-655)+(1.011)+(1.055), (I-655)+(1.011)+(1.056), (I-655)+(1.011)+(1.057), (I-655)+(1.011)+(1.058), (I-655)+(1.011)+(1.059), (I-655)+(1.011)+(1.060), (I-655)+(1.011)+(1.061), (I-655)+(1.011)+(1.062), (I-655)+(1.011)+(1.063), (I-655)+(1.011)+(1.064), (I-655)+(1.011)+(1.065), (I-655)+(1.011)+(1.066), (I-655)+(1.011)+(1.067), (I-655)+(1.011)+(1.068), (I-655)+(1.011)+(1.069), (I-655)+(1.011)+(1.070), (I-655)+(1.011)+(1.071), (I-655)+(1.011)+(1.072), (I-655)+(1.011)+(1.073), (I-655)+(1.011)+(1.074), (I-655)+(1.011)+(1.075), (I-655)+(1.011)+(1.076), (I-655)+(1.011)+(1.077), (I-655)+(1.011)+(1.078), (I-655)+(1.011)+(1.079), (I-655)+(1.011)+(1.080), (I-655)+(1.011)+(1.081), (I-655)+(1.011)+(1.082), (I-655)+(1.011)+(1.083), (I-655)+(1.011)+(1.084), (I-655)+(1.011)+(1.085), (I-655)+(1.011)+(1.086), (I-655)+(1.011)+(1.087), (I-655)+(1.011)+(1.088), (I-655)+(1.011)+(1.089), (I-655)+(1.011)+(1.090), (I-655)+(1.011)+(1.091), (I-655)+(1.011)+(1.092), (I-655)+(1.011)+(2.001), (I-655)+(1.011)+(2.002), (I-655)+(1.011)+(2.003), (I-655)+(1.011)+(2.004), (I-655)+(1.011)+(2.005), (I-655)+(1.011)+(2.006), (I-655)+(1.011)+(2.007), (I-655)+(1.011)+(2.008), (I-655)+(1.011)+(2.009), (I-655)+(1.011)+(2.010), (I-655)+(1.011)+(2.011), (I-655)+(1.011)+(2.012), (I-655)+(1.011)+(2.013), (I-655)+(1.011)+(2.014), (I-655)+(1.011)+(2.015), (I-655)+(1.011)+(2.016), (I-655)+(1.011)+(2.017), (I-655)+(1.011)+(2.018), (I-655)+(1.011)+(2.019), (I-655)+(1.011)+(2.020), (I-655)+(1.011)+(2.021), (I-655)+(1.011)+(2.022), (I-655)+(1.011)+(2.023), (I-655)+(1.011)+(2.024), (I-655)+(1.011)+(2.025), (I-655)+(1.011)+(2.026), (I-655)+(1.011)+(2.027), (I-655)+(1.011)+(2.028), (I-655)+(1.011)+(2.029), (I-655)+(1.011)+(2.030), (I-655)+(1.011)+(2.031), (I-655)+(1.011)+(2.032), (I-655)+(1.011)+(2.033), (I-655)+(1.011)+(2.034), (I-655)+(1.011)+(2.035), (I-655)+(1.011)+(2.036), (I-655)+(1.011)+(2.037), (I-655)+(1.011)+(2.038), (I-655)+(1.011)+(2.039), (I-655)+(1.011)+(2.040), (I-655)+(1.011)+(2.041), (I-655)+(1.011)+(2.042), (I-655)+(1.011)+(2.043), (I-655)+(1.011)+(2.044), (I-655)+(1.011)+(2.045), (I-655)+(1.011)+(2.046), (I-655)+(1.011)+(2.047), (I-655)+(1.011)+(2.048), (I-655)+(1.011)+(2.049), (I-655)+(1.011)+(2.050), (I-655)+(1.011)+(2.051), (I-655)+(1.011)+(2.052), (I-655)+(1.011)+(2.053), (I-655)+(1.011)+(2.054), (I-655)+(1.011)+(2.055), (I-655)+(1.011)+(2.056), (I-655)+(1.011)+(2.057), (I-655)+(1.011)+(2.058), (I-655)+(1.011)+(2.059), (I-655)+(1.011)+(3.001), (I-655)+(1.011)+(3.002), (I-655)+(1.011)+(3.003), (I-655)+(1.011)+(3.004), (I-655)+(1.011)+(3.005), (I-655)+(1.011)+(3.006), (I-655)+(1.011)+(3.007), (I-655)+(1.011)+(3.008), (I-655)+(1.011)+(3.009), (I-655)+(1.011)+(3.010), (I-655)+(1.011)+(3.011), (I-655)+(1.011)+(3.012), (I-655)+(1.011)+(3.013), (I-655)+(1.011)+(3.014), (I-655)+(1.011)+(3.015), (I-655)+(1.011)+(3.016), (I-655)+(1.011)+(3.017), (I-655)+(1.011)+(3.018), (I-655)+(1.011)+(3.019), (I-655)+(1.011)+(3.020), (I-655)+(1.011)+(3.021), (I-655)+(1.011)+(3.022), (I-655)+(1.011)+(3.023), (I-655)+(1.011)+(3.024), (I-655)+(1.011)+(3.025), (I-655)+(1.011)+(3.026), (I-655)+(1.011)+(3.027), (I-655)+(1.011)+(3.028), (I-655)+(1.011)+(3.029), (I-655)+(1.011)+(3.030), (I-655)+(1.011)+(3.031), (I-655)+(1.011)+(5.001), (I-655)+(1.011)+(5.002), (I-655)+(1.011)+(5.003), (I-655)+(1.011)+(5.004), (I-655)+(1.011)+(5.005), (I-655)+(1.011)+(5.006), (I-655)+(1.011)+(5.007), (I-655)+(1.011)+(5.008), (I-655)+(1.011)+(5.009), (I-655)+(1.011)+(5.010), (I-655)+(1.011)+(5.011), (I-655)+(1.011)+(5.012), (I-655)+(1.011)+(5.013), (I-655)+(1.011)+(5.014), (I-655)+(1.011)+(5.015), (I-655)+(1.011)+(5.016), (I-655)+(1.011)+(5.017), (I-655)+(1.011)+(5.018), (I-655)+(1.011)+(5.019), (I-655)+(1.011)+(5.020), (I-655)+(1.011)+(5.021), (I-655)+(1.011)+(5.022), (I-655)+(1.011)+(5.023), (I-655)+(1.011)+(6.001), (I-655)+(1.011)+(6.002), (I-655)+(1.011)+(6.003), (I-655)+(1.011)+(6.004), (I-655)+(1.011)+(7.001), (I-655)+(1.011)+(7.002), (I-655)+(1.011)+(7.003), (I-655)+(1.011)+(7.004), (I-655)+(1.011)+(7.005), (I-655)+(1.011)+(7.006), (I-655)+(1.011)+(9.001), (I-655)+(1.011)+(9.002), (I-655)+(1.011)+(9.003), (I-655)+(1.011)+(9.004), (I-655)+(1.011)+(9.005), (I-655)+(1.011)+(9.006), (I-655)+(1.011)+(9.007), (I-655)+(1.011)+(9.008), (I-655)+(1.011)+(9.009), (I-655)+(1.011)+(14.001), (I-655)+(1.011)+(14.002), (I-655)+(1.011)+(15.008), (I-655)+(1.011)+(15.011), (I-655)+(1.011)+(15.012), (I-655)+(1.011)+(15.016), (I-655)+(1.011)+(15.025), (I-655)+(1.011)+(15.027), (I-655)+(1.011)+(15.047), (I-655)+(1.011)+(15.063), (I-655)+(1.011)+(15.064), (I-655)+(1.011)+(16.001), (I-655)+(1.011)+(16.002), (I-655)+(1.011)+(16.003), (I-655)+(1.011)+(16.004), (I-655)+(1.011)+(16.005), (I-655)+(1.011)+(16.006), (I-655)+(1.011)+(16.007), (I-655)+(1.011)+(16.008), (I-655)+(1.011)+(17.001), (I-655)+(1.011)+(17.002), (I-655)+(1.011)+(17.003), (I-655)+(1.011)+(17.004), (I-655)+(1.011)+(17.005), (I-655)+(1.011)+(17.006), (I-655)+(1.011)+(17.007), (I-655)+(1.011)+(17.008), (I-655)+(1.011)+(17.009), (I-655)+(1.011)+(17.010), (I-655)+(1.011)+(17.011), (I-655)+(1.011)+(17.012), (I-655)+(1.011)+(18.001),

(I-655)+(1.012)+(1.013), (I-655)+(1.012)+(1.014), (I-655)+(1.012)+(1.015), (I-655)+(1.012)+(1.016), (I-655)+(1.012)+(1.017), (I-655)+(1.012)+(1.018), (I-655)+(1.012)+(1.019), (I-655)+(1.012)+(1.020), (I-655)+(1.012)+(1.021), (I-655)+(1.012)+(1.022), (I-655)+(1.012)+(1.023), (I-655)+(1.012)+(1.024), (I-655)+(1.012)+(1.025), (I-655)+(1.012)+(1.026), (I-655)+(1.012)+(1.027), (I-655)+(1.012)+(1.028), (I-655)+(1.012)+(1.029), (I-655)+(1.012)+(1.030), (I-655)+(1.012)+(1.031), (I-655)+(1.012)+(1.032), (I-655)+(1.012)+(1.033), (I-655)+(1.012)+(1.034), (I-655)+(1.012)+(1.035), (I-655)+(1.012)+(1.036), (I-655)+(1.012)+(1.037), (I-655)+(1.012)+(1.038), (I-655)+(1.012)+(1.039), (I-655)+(1.012)+(1.040), (I-655)+(1.012)+(1.041), (I-655)+(1.012)+(1.042), (I-655)+(1.012)+(1.043), (I-655)+(1.012)+(1.044), (I-655)+(1.012)+(1.045), (I-655)+(1.012)+(1.046), (I-655)+(1.012)+(1.047), (I-655)+(1.012)+(1.048), (I-655)+(1.012)+(1.049), (I-655)+(1.012)+(1.050), (I-655)+(1.012)+(1.051), (I-655)+(1.012)+(1.052), (I-655)+(1.012)+(1.053), (I-655)+(1.012)+(1.054), (I-655)+(1.012)+(1.055), (I-655)+(1.012)+(1.056), (I-655)+(1.012)+(1.057), (I-655)+(1.012)+(1.058), (I-655)+(1.012)+(1.059), (I-655)+(1.012)+(1.060), (I-655)+(1.012)+(1.061), (I-655)+(1.012)+(1.062), (I-655)+(1.012)+(1.063), (I-655)+(1.012)+(1.064), (I-655)+(1.012)+(1.065), (I-655)+(1.012)+(1.066), (I-655)+(1.012)+(1.067), (I-655)+(1.012)+(1.068), (I-655)+(1.012)+(1.069), (I-655)+(1.012)+(1.070), (I-655)+(1.012)+(1.071), (I-655)+(1.012)+(1.072), (I-655)+(1.012)+(1.073), (I-655)+(1.012)+(1.074), (I-655)+(1.012)+(1.075), (I-655)+(1.012)+(1.076), (I-655)+(1.012)+(1.077), (I-655)+(1.012)+(1.078), (I-655)+(1.012)+(1.079), (I-655)+(1.012)+(1.080), (I-655)+(1.012)+(1.081), (I-655)+(1.012)+(1.082), (I-655)+(1.012)+(1.083), (I-655)+(1.012)+(1.084), (I-655)+(1.012)+(1.085), (I-655)+(1.012)+(1.086), (I-655)+(1.012)+(1.087), (I-655)+(1.012)+(1.088), (I-655)+(1.012)+(1.089), (I-655)+(1.012)+(1.090), (I-655)+(1.012)+(1.091), (I-655)+(1.012)+(1.092), (I-655)+(1.012)+(2.001), (I-655)+(1.012)+(2.002), (I-655)+(1.012)+(2.003), (I-655)+(1.012)+(2.004), (I-655)+(1.012)+(2.005), (I-655)+(1.012)+(2.006), (I-655)+(1.012)+(2.007), (I-655)+(1.012)+(2.008), (I-655)+(1.012)+(2.009), (I-655)+(1.012)+(2.010), (I-655)+(1.012)+(2.011), (I-655)+(1.012)+(2.012), (I-655)+(1.012)+(2.013), (I-655)+(1.012)+(2.014), (I-655)+(1.012)+(2.015), (I-655)+(1.012)+(2.016), (I-655)+(1.012)+(2.017), (I-655)+(1.012)+(2.018), (I-655)+(1.012)+(2.019), (I-655)+(1.012)+(2.020), (I-655)+(1.012)+(2.021), (I-655)+(1.012)+(2.022), (I-655)+(1.012)+(2.023), (I-655)+(1.012)+(2.024), (I-655)+(1.012)+(2.025), (I-655)+(1.012)+(2.026), (I-655)+(1.012)+(2.027), (I-655)+(1.012)+(2.028), (I-655)+(1.012)+(2.029), (I-655)+(1.012)+(2.030), (I-655)+(1.012)+(2.031), (I-655)+(1.012)+(2.032), (I-655)+(1.012)+(2.033), (I-655)+(1.012)+(2.034), (I-655)+(1.012)+(2.035), (I-655)+(1.012)+(2.036), (I-655)+(1.012)+(2.037), (I-655)+(1.012)+(2.038), (I-655)+(1.012)+(2.039), (I-655)+(1.012)+(2.040), (I-655)+(1.012)+(2.041), (I-655)+(1.012)+(2.042), (I-655)+(1.012)+(2.043), (I-655)+(1.012)+(2.044), (I-655)+(1.012)+(2.045), (I-655)+(1.012)+(2.046), (I-655)+(1.012)+(2.047), (I-655)+(1.012)+(2.048), (I-655)+(1.012)+(2.049), (I-655)+(1.012)+(2.050), (I-655)+(1.012)+(2.051), (I-655)+(1.012)+(2.052), (I-655)+(1.012)+(2.053), (I-655)+(1.012)+(2.054), (I-655)+(1.012)+(2.055), (I-655)+(1.012)+(2.056), (I-655)+(1.012)+(2.057), (I-655)+(1.012)+(2.058), (I-655)+(1.012)+(2.059), (I-655)+(1.012)+(3.001), (I-655)+(1.012)+(3.002), (I-655)+(1.012)+(3.003), (I-655)+(1.012)+(3.004), (I-655)+(1.012)+(3.005), (I-655)+(1.012)+(3.006), (I-655)+(1.012)+(3.007), (I-655)+(1.012)+(3.008), (I-655)+(1.012)+(3.009), (I-655)+(1.012)+(3.010), (I-655)+(1.012)+(3.011), (I-655)+(1.012)+(3.012), (I-655)+(1.012)+(3.013), (I-655)+(1.012)+(3.014), (I-655)+(1.012)+(3.015), (I-655)+(1.012)+(3.016), (I-655)+(1.012)+(3.017), (I-655)+(1.012)+(3.018), (I-655)+(1.012)+(3.019), (I-655)+(1.012)+(3.020), (I-655)+(1.012)+(3.021), (I-655)+(1.012)+(3.022), (I-655)+(1.012)+(3.023), (I-655)+(1.012)+(3.024), (I-655)+(1.012)+(3.025), (I-655)+(1.012)+(3.026), (I-655)+(1.012)+(3.027), (I-655)+(1.012)+(3.028), (I-655)+(1.012)+(3.029), (I-655)+(1.012)+(3.030), (I-655)+(1.012)+(3.031), (I-655)+(1.012)+(5.001), (I-655)+(1.012)+(5.002), (I-655)+(1.012)+(5.003), (I-655)+(1.012)+(5.004), (I-655)+(1.012)+(5.005), (I-655)+(1.012)+(5.006), (I-655)+(1.012)+(5.007), (I-655)+(1.012)+(5.008), (I-655)+(1.012)+(5.009), (I-655)+(1.012)+(5.010), (I-655)+(1.012)+(5.011), (I-655)+(1.012)+(5.012), (I-655)+(1.012)+(5.013), (I-655)+(1.012)+(5.014), (I-655)+(1.012)+(5.015), (I-655)+(1.012)+(5.016), (I-655)+(1.012)+(5.017), (I-655)+(1.012)+(5.018), (I-655)+(1.012)+(5.019), (I-655)+(1.012)+(5.020), (I-655)+(1.012)+(5.021), (I-655)+(1.012)+(5.022), (I-655)+(1.012)+(5.023), (I-655)+(1.012)+(6.001), (I-655)+(1.012)+(6.002), (I-655)+(1.012)+(6.003), (I-655)+(1.012)+(6.004), (I-655)+(1.012)+(7.001), (I-655)+(1.012)+(7.002), (I-655)+(1.012)+(7.003), (I-655)+(1.012)+(7.004), (I-655)+(1.012)+(7.005), (I-655)+(1.012)+(7.006), (I-655)+(1.012)+(9.001), (I-655)+(1.012)+(9.002), (I-655)+(1.012)+(9.003), (I-655)+(1.012)+(9.004), (I-655)+(1.012)+(9.005), (I-655)+(1.012)+(9.006), (I-655)+(1.012)+(9.007), (I-655)+(1.012)+(9.008), (I-655)+(1.012)+(9.009), (I-655)+(1.012)+(14.001), (I-655)+(1.012)+(14.002), (I-655)+(1.012)+(15.008), (I-655)+(1.012)+(15.011), (I-655)+(1.012)+(15.012), (I-655)+(1.012)+(15.016), (I-655)+(1.012)+(15.025), (I-655)+(1.012)+(15.027), (I-655)+(1.012)+(15.047), (I-655)+(1.012)+(15.063), (I-655)+(1.012)+(15.064), (I-655)+(1.012)+(16.001), (I-655)+(1.012)+(16.002), (I-655)+(1.012)+(16.003), (I-655)+(1.012)+(16.004), (I-655)+(1.012)+(16.005), (I-655)+(1.012)+(16.006), (I-655)+(1.012)+(16.007), (I-655)+(1.012)+(16.008), (I-655)+(1.012)+(17.001), (I-655)+(1.012)+(17.002), (I-655)+(1.012)+(17.003), (I-655)+(1.012)+(17.004), (I-655)+(1.012)+(17.005), (I-655)+(1.012)+(17.006), (I-655)+(1.012)+(17.007), (I-655)+(1.012)+(17.008), (I-655)+(1.012)+(17.009), (I-655)+(1.012)+(17.010), (I-655)+(1.012)+(17.011), (I-655)+(1.012)+(17.012), (I-655)+(1.012)+(18.001),

(I-655)+(1.013)+(1.014), (I-655)+(1.013)+(1.015), (I-655)+(1.013)+(1.016), (I-655)+(1.013)+(1.017), (I-655)+(1.013)+(1.018), (I-655)+(1.013)+(1.019), (I-655)+(1.013)+(1.020), (I-655)+(1.013)+(1.021), (I-655)+(1.013)+(1.022), (I-655)+(1.013)+(1.023), (I-655)+(1.013)+(1.024), (I-655)+(1.013)+(1.025), (I-655)+(1.013)+(1.026), (I-655)+(1.013)+(1.027), (I-655)+(1.013)+(1.028), (I-655)+(1.013)+(1.029), (I-655)+(1.013)+(1.030), (I-655)+(1.013)+(1.031), (I-655)+(1.013)+(1.032), (I-655)+(1.013)+(1.033), (I-655)+(1.013)+(1.034), (I-655)+(1.013)+(1.035), (I-655)+(1.013)+(1.036), (I-655)+(1.013)+(1.037), (I-655)+(1.013)+(1.038), (I-655)+(1.013)+(1.039), (I-655)+(1.013)+(1.040), (I-655)+(1.013)+(1.041), (I-655)+(1.013)+(1.042), (I-655)+(1.013)+(1.043), (I-655)+(1.013)+(1.044), (I-655)+(1.013)+(1.045), (I-655)+(1.013)+(1.046), (I-655)+(1.013)+(1.047), (I-655)+(1.013)+(1.048), (I-655)+(1.013)+(1.049), (I-655)+(1.013)+(1.050), (I-655)+(1.013)+(1.051), (I-655)+(1.013)+(1.052), (I-655)+(1.013)+(1.053), (I-655)+(1.013)+(1.054), (I-655)+(1.013)+(1.055), (I-655)+(1.013)+(1.056), (I-655)+(1.013)+(1.057), (I-655)+(1.013)+(1.058), (I-655)+(1.013)+(1.059), (I-655)+(1.013)+(1.060), (I-655)+(1.013)+(1.061), (I-655)+(1.013)+(1.062), (I-655)+(1.013)+(1.063), (I-655)+(1.013)+(1.064), (I-655)+(1.013)+(1.065), (I-655)+(1.013)+(1.066), (I-655)+(1.013)+(1.067), (I-655)+(1.013)+(1.068), (I-655)+(1.013)+(1.069), (I-655)+(1.013)+(1.070), (I-655)+(1.013)+(1.071), (I-655)+(1.013)+(1.072), (I-655)+(1.013)+(1.073), (I-655)+(1.013)+(1.074), (I-655)+(1.013)+(1.075), (I-655)+(1.013)+(1.076), (I-655)+(1.013)+(1.077), (I-655)+(1.013)+(1.078), (I-655)+(1.013)+(1.079), (I-655)+(1.013)+(1.080), (I-655)+(1.013)+(1.081), (I-655)+(1.013)+(1.082), (I-655)+(1.013)+(1.083), (I-655)+(1.013)+(1.084), (I-655)+(1.013)+(1.085), (I-655)+(1.013)+(1.086), (I-655)+(1.013)+(1.087), (I-655)+(1.013)+(1.088), (I-655)+(1.013)+(1.089), (I-655)+(1.013)+(1.090), (I-655)+(1.013)+(1.091), (I-655)+(1.013)+(1.092), (I-655)+(1.013)+(2.001), (I-655)+(1.013)+(2.002), (I-655)+(1.013)+(2.003), (I-655)+(1.013)+(2.004), (I-655)+(1.013)+(2.005), (I-655)+(1.013)+(2.006), (I-655)+(1.013)+(2.007), (I-655)+(1.013)+(2.008), (I-655)+(1.013)+(2.009), (I-655)+(1.013)+(2.010), (I-655)+(1.013)+(2.011), (I-655)+(1.013)+(2.012), (I-655)+(1.013)+(2.013), (I-655)+(1.013)+(2.014), (I-655)+(1.013)+(2.015), (I-655)+(1.013)+(2.016), (I-655)+(1.013)+(2.017), (I-655)+(1.013)+(2.018), (I-655)+(1.013)+(2.019), (I-655)+(1.013)+(2.020), (I-655)+(1.013)+(2.021), (I-655)+(1.013)+(2.022), (I-655)+(1.013)+(2.023), (I-655)+(1.013)+(2.024), (I-655)+(1.013)+(2.025), (I-655)+(1.013)+(2.026), (I-655)+(1.013)+(2.027), (I-655)+(1.013)+(2.028), (I-655)+(1.013)+(2.029), (I-655)+(1.013)+(2.030), (I-655)+(1.013)+(2.031), (I-655)+(1.013)+(2.032), (I-655)+(1.013)+(2.033), (I-655)+(1.013)+(2.034), (I-655)+(1.013)+(2.035), (I-655)+(1.013)+(2.036), (I-655)+(1.013)+(2.037), (I-655)+(1.013)+(2.038), (I-655)+(1.013)+(2.039), (I-655)+(1.013)+(2.040), (I-655)+(1.013)+(2.041), (I-655)+(1.013)+(2.042), (I-655)+(1.013)+(2.043), (I-655)+(1.013)+(2.044), (I-655)+(1.013)+(2.045), (I-655)+(1.013)+(2.046), (I-655)+(1.013)+(2.047), (I-655)+(1.013)+(2.048), (I-655)+(1.013)+(2.049), (I-655)+(1.013)+(2.050), (I-655)+(1.013)+(2.051), (I-655)+(1.013)+(2.052), (I-655)+(1.013)+(2.053), (I-655)+(1.013)+(2.054), (I-655)+(1.013)+(2.055), (I-655)+(1.013)+(2.056), (I-655)+(1.013)+(2.057), (I-655)+(1.013)+(2.058), (I-655)+(1.013)+(2.059), (I-655)+(1.013)+(3.001), (I-655)+(1.013)+(3.002), (I-655)+(1.013)+(3.003), (I-655)+(1.013)+(3.004), (I-655)+(1.013)+(3.005), (I-655)+(1.013)+(3.006), (I-655)+(1.013)+(3.007), (I-655)+(1.013)+(3.008), (I-655)+(1.013)+(3.009), (I-655)+(1.013)+(3.010), (I-655)+(1.013)+(3.011), (I-655)+(1.013)+(3.012), (I-655)+(1.013)+(3.013), (I-655)+(1.013)+(3.014), (I-655)+(1.013)+(3.015), (I-655)+(1.013)+(3.016), (I-655)+(1.013)+(3.017), (I-655)+(1.013)+(3.018), (I-655)+(1.013)+(3.019), (I-655)+(1.013)+(3.020), (I-655)+(1.013)+(3.021), (I-655)+(1.013)+(3.022), (I-655)+(1.013)+(3.023), (I-655)+(1.013)+(3.024), (I-655)+(1.013)+(3.025), (I-655)+(1.013)+(3.026), (I-655)+(1.013)+(3.027), (I-655)+(1.013)+(3.028), (I-655)+(1.013)+(3.029), (I-655)+(1.013)+(3.030), (I-655)+(1.013)+(3.031), (I-655)+(1.013)+(5.001), (I-655)+(1.013)+(5.002), (I-655)+(1.013)+(5.003), (I-655)+(1.013)+(5.004), (I-655)+(1.013)+(5.005), (I-655)+(1.013)+(5.006), (I-655)+(1.013)+(5.007), (I-655)+(1.013)+(5.008), (I-655)+(1.013)+(5.009), (I-655)+(1.013)+(5.010), (I-655)+(1.013)+(5.011), (I-655)+(1.013)+(5.012), (I-655)+(1.013)+(5.013), (I-655)+(1.013)+(5.014), (I-655)+(1.013)+(5.015), (I-655)+(1.013)+(5.016), (I-655)+(1.013)+(5.017), (I-655)+(1.013)+(5.018), (I-655)+(1.013)+(5.019), (I-655)+(1.013)+(5.020), (I-655)+(1.013)+(5.021), (I-655)+(1.013)+(5.022), (I-655)+(1.013)+(5.023), (I-655)+(1.013)+(6.001), (I-655)+(1.013)+(6.002), (I-655)+(1.013)+(6.003), (I-655)+(1.013)+(6.004), (I-655)+(1.013)+(7.001), (I-655)+(1.013)+(7.002), (I-655)+(1.013)+(7.003), (I-655)+(1.013)+(7.004), (I-655)+(1.013)+(7.005), (I-655)+(1.013)+(7.006), (I-655)+(1.013)+(9.001), (I-655)+(1.013)+(9.002), (I-655)+(1.013)+(9.003), (I-655)+(1.013)+(9.004), (I-655)+(1.013)+(9.005), (I-655)+(1.013)+(9.006), (I-655)+(1.013)+(9.007), (I-655)+(1.013)+(9.008), (I-655)+(1.013)+(9.009), (I-655)+(1.013)+(14.001), (I-655)+(1.013)+(14.002), (I-655)+(1.013)+(15.008), (I-655)+(1.013)+(15.011), (I-655)+(1.013)+(15.012), (I-655)+(1.013)+(15.016), (I-655)+(1.013)+(15.025), (I-655)+(1.013)+(15.027), (I-655)+(1.013)+(15.047), (I-655)+(1.013)+(15.063), (I-655)+(1.013)+(15.064), (I-655)+(1.013)+(16.001), (I-655)+(1.013)+(16.002), (I-655)+(1.013)+(16.003), (I-655)+(1.013)+(16.004), (I-655)+(1.013)+(16.005), (I-655)+(1.013)+(16.006), (I-655)+(1.013)+(16.007), (I-655)+(1.013)+(16.008), (I-655)+(1.013)+(17.001), (I-655)+(1.013)+(17.002), (I-655)+(1.013)+(17.003), (I-655)+(1.013)+(17.004), (I-655)+(1.013)+(17.005), (I-655)+(1.013)+(17.006), (I-655)+(1.013)+(17.007), (I-655)+(1.013)+(17.008), (I-655)+(1.013)+(17.009), (I-655)+(1.013)+(17.010), (I-655)+(1.013)+(17.011), (I-655)+(1.013)+(17.012), (I-655)+(1.013)+(18.001),

(I-655)+(1.014)+(1.015), (I-655)+(1.014)+(1.016), (I-655)+(1.014)+(1.017), (I-655)+(1.014)+(1.018), (I-655)+(1.014)+(1.019), (I-655)+(1.014)+(1.020), (I-655)+(1.014)+(1.021), (I-655)+(1.014)+(1.022), (I-655)+(1.014)+(1.023), (I-655)+(1.014)+(1.024), (I-655)+(1.014)+(1.025), (I-655)+(1.014)+(1.026), (I-655)+(1.014)+(1.027), (I-655)+(1.014)+(1.028), (I-655)+(1.014)+(1.029), (I-655)+(1.014)+(1.030), (I-655)+(1.014)+(1.031), (I-655)+(1.014)+(1.032), (I-655)+(1.014)+(1.033), (I-655)+(1.014)+(1.034), (I-655)+(1.014)+(1.035), (I-655)+(1.014)+(1.036), (I-655)+(1.014)+(1.037), (I-655)+(1.014)+(1.038), (I-655)+(1.014)+(1.039), (I-655)+(1.014)+(1.040), (I-655)+(1.014)+(1.041), (I-655)+(1.014)+(1.042), (I-655)+(1.014)+(1.043), (I-655)+(1.014)+(1.044), (I-655)+(1.014)+(1.045), (I-655)+(1.014)+(1.046), (I-655)+(1.014)+(1.047), (I-655)+(1.014)+(1.048), (I-655)+(1.014)+(1.049), (I-655)+(1.014)+(1.050), (I-655)+(1.014)+(1.051), (I-655)+(1.014)+(1.052), (I-655)+(1.014)+(1.053), (I-655)+(1.014)+(1.054), (I-655)+(1.014)+(1.055), (I-655)+(1.014)+(1.056), (I-655)+(1.014)+(1.057), (I-655)+(1.014)+(1.058), (I-655)+(1.014)+(1.059), (I-655)+(1.014)+(1.060), (I-655)+(1.014)+(1.061), (I-655)+(1.014)+(1.062), (I-655)+(1.014)+(1.063), (I-655)+(1.014)+(1.064), (I-655)+(1.014)+(1.065), (I-655)+(1.014)+(1.066), (I-655)+(1.014)+(1.067), (I-655)+(1.014)+(1.068), (I-655)+(1.014)+(1.069), (I-655)+(1.014)+(1.070), (I-655)+(1.014)+(1.071), (I-655)+(1.014)+(1.072), (I-655)+(1.014)+(1.073), (I-655)+(1.014)+(1.074), (I-655)+(1.014)+(1.075), (I-655)+(1.014)+(1.076), (I-655)+(1.014)+(1.077), (I-655)+(1.014)+(1.078), (I-655)+(1.014)+(1.079), (I-655)+(1.014)+(1.080), (I-655)+(1.014)+(1.081), (I-655)+(1.014)+(1.082), (I-655)+(1.014)+(1.083), (I-655)+(1.014)+(1.084), (I-655)+(1.014)+(1.085), (I-655)+(1.014)+(1.086), (I-655)+(1.014)+(1.087), (I-655)+(1.014)+(1.088), (I-655)+(1.014)+(1.089), (I-655)+(1.014)+(1.090), (I-655)+(1.014)+(1.091), (I-655)+(1.014)+(1.092), (I-655)+(1.014)+(2.001), (I-655)+(1.014)+(2.002), (I-655)+(1.014)+(2.003), (I-655)+(1.014)+(2.004), (I-655)+(1.014)+(2.005), (I-655)+(1.014)+(2.006), (I-655)+(1.014)+(2.007), (I-655)+(1.014)+(2.008), (I-655)+(1.014)+(2.009), (I-655)+(1.014)+(2.010), (I-655)+(1.014)+(2.011), (I-655)+(1.014)+(2.012), (I-655)+(1.014)+(2.013), (I-655)+(1.014)+(2.014), (I-655)+(1.014)+(2.015), (I-655)+(1.014)+(2.016), (I-655)+(1.014)+(2.017), (I-655)+(1.014)+(2.018), (I-655)+(1.014)+(2.019), (I-655)+(1.014)+(2.020), (I-655)+(1.014)+(2.021), (I-655)+(1.014)+(2.022), (I-655)+(1.014)+(2.023), (I-655)+(1.014)+(2.024), (I-655)+(1.014)+(2.025), (I-655)+(1.014)+(2.026), (I-655)+(1.014)+(2.027), (I-655)+(1.014)+(2.028), (I-655)+(1.014)+(2.029), (I-655)+(1.014)+(2.030), (I-655)+(1.014)+(2.031), (I-655)+(1.014)+(2.032), (I-655)+(1.014)+(2.033), (I-655)+(1.014)+(2.034), (I-655)+(1.014)+(2.035), (I-655)+(1.014)+(2.036), (I-655)+(1.014)+(2.037), (I-655)+(1.014)+(2.038), (I-655)+(1.014)+(2.039), (I-655)+(1.014)+(2.040), (I-655)+(1.014)+(2.041), (I-655)+(1.014)+(2.042), (I-655)+(1.014)+(2.043), (I-655)+(1.014)+(2.044), (I-655)+(1.014)+(2.045), (I-655)+(1.014)+(2.046), (I-655)+(1.014)+(2.047), (I-655)+(1.014)+(2.048), (I-655)+(1.014)+(2.049), (I-655)+(1.014)+(2.050), (I-655)+(1.014)+(2.051), (I-655)+(1.014)+(2.052), (I-655)+(1.014)+(2.053), (I-655)+(1.014)+(2.054), (I-655)+(1.014)+(2.055), (I-655)+(1.014)+(2.056), (I-655)+(1.014)+(2.057), (I-655)+(1.014)+(2.058), (I-655)+(1.014)+(2.059), (I-655)+(1.014)+(3.001), (I-655)+(1.014)+(3.002), (I-655)+(1.014)+(3.003), (I-655)+(1.014)+(3.004), (I-655)+(1.014)+(3.005), (I-655)+(1.014)+(3.006), (I-655)+(1.014)+(3.007), (I-655)+(1.014)+(3.008), (I-655)+(1.014)+(3.009), (I-655)+(1.014)+(3.010), (I-655)+(1.014)+(3.011), (I-655)+(1.014)+(3.012), (I-655)+(1.014)+(3.013), (I-655)+(1.014)+(3.014), (I-655)+(1.014)+(3.015), (I-655)+(1.014)+(3.016), (I-655)+(1.014)+(3.017), (I-655)+(1.014)+(3.018), (I-655)+(1.014)+(3.019), (I-655)+(1.014)+(3.020), (I-655)+(1.014)+(3.021), (I-655)+(1.014)+(3.022), (I-655)+(1.014)+(3.023), (I-655)+(1.014)+(3.024), (I-655)+(1.014)+(3.025), (I-655)+(1.014)+(3.026), (I-655)+(1.014)+(3.027), (I-655)+(1.014)+(3.028), (I-655)+(1.014)+(3.029), (I-655)+(1.014)+(3.030), (I-655)+(1.014)+(3.031), (I-655)+(1.014)+(5.001), (I-655)+(1.014)+(5.002), (I-655)+(1.014)+(5.003), (I-655)+(1.014)+(5.004), (I-655)+(1.014)+(5.005), (I-655)+(1.014)+(5.006), (I-655)+(1.014)+(5.007), (I-655)+(1.014)+(5.008), (I-655)+(1.014)+(5.009), (I-655)+(1.014)+(5.010), (I-655)+(1.014)+(5.011), (I-655)+(1.014)+(5.012), (I-655)+(1.014)+(5.013), (I-655)+(1.014)+(5.014), (I-655)+(1.014)+(5.015), (I-655)+(1.014)+(5.016), (I-655)+(1.014)+(5.017), (I-655)+(1.014)+(5.018), (I-655)+(1.014)+(5.019), (I-655)+(1.014)+(5.020), (I-655)+(1.014)+(5.021), (I-655)+(1.014)+(5.022), (I-655)+(1.014)+(5.023), (I-655)+(1.014)+(6.001), (I-655)+(1.014)+(6.002), (I-655)+(1.014)+(6.003), (I-655)+(1.014)+(6.004), (I-655)+(1.014)+(7.001), (I-655)+(1.014)+(7.002), (I-655)+(1.014)+(7.003), (I-655)+(1.014)+(7.004), (I-655)+(1.014)+(7.005), (I-655)+(1.014)+(7.006), (I-655)+(1.014)+(9.001), (I-655)+(1.014)+(9.002), (I-655)+(1.014)+(9.003), (I-655)+(1.014)+(9.004), (I-655)+(1.014)+(9.005), (I-655)+(1.014)+(9.006), (I-655)+(1.014)+(9.007), (I-655)+(1.014)+(9.008), (I-655)+(1.014)+(9.009), (I-655)+(1.014)+(14.001), (I-655)+(1.014)+(14.002), (I-655)+(1.014)+(15.008), (I-655)+(1.014)+(15.011), (I-655)+(1.014)+(15.012), (I-655)+(1.014)+(15.016), (I-655)+(1.014)+(15.025), (I-655)+(1.014)+(15.027), (I-655)+(1.014)+(15.047), (I-655)+(1.014)+(15.063), (I-655)+(1.014)+(15.064), (I-655)+(1.014)+(16.001), (I-655)+(1.014)+(16.002), (I-655)+(1.014)+(16.003), (I-655)+(1.014)+(16.004), (I-655)+(1.014)+(16.005), (I-655)+(1.014)+(16.006), (I-655)+(1.014)+(16.007), (I-655)+(1.014)+(16.008), (I-655)+(1.014)+(17.001), (I-655)+(1.014)+(17.002), (I-655)+(1.014)+(17.003), (I-655)+(1.014)+(17.004), (I-655)+(1.014)+(17.005), (I-655)+(1.014)+(17.006), (I-655)+(1.014)+(17.007), (I-655)+(1.014)+(17.008), (I-655)+(1.014)+(17.009), (I-655)+(1.014)+(17.010), (I-655)+(1.014)+(17.011), (I-655)+(1.014)+(17.012), (I-655)+(1.014)+(18.001),

(I-655)+(1.015)+(1.016), (I-655)+(1.015)+(1.017), (I-655)+(1.015)+(1.018), (I-655)+(1.015)+(1.019), (I-655)+(1.015)+(1.020), (I-655)+(1.015)+(1.021), (I-655)+(1.015)+(1.022), (I-655)+(1.015)+(1.023), (I-655)+(1.015)+(1.024), (I-655)+(1.015)+(1.025), (I-655)+(1.015)+(1.026), (I-655)+(1.015)+(1.027), (I-655)+(1.015)+(1.028), (I-655)+(1.015)+(1.029), (I-655)+(1.015)+(1.030), (I-655)+(1.015)+(1.031), (I-655)+(1.015)+(1.032), (I-655)+(1.015)+(1.033), (I-655)+(1.015)+(1.034), (I-655)+(1.015)+(1.035), (I-655)+(1.015)+(1.036), (I-655)+(1.015)+(1.037), (I-655)+(1.015)+(1.038), (I-655)+(1.015)+(1.039), (I-655)+(1.015)+(1.040), (I-655)+(1.015)+(1.041), (I-655)+(1.015)+(1.042), (I-655)+(1.015)+(1.043), (I-655)+(1.015)+(1.044), (I-655)+(1.015)+(1.045), (I-655)+(1.015)+(1.046), (I-655)+(1.015)+(1.047), (I-655)+(1.015)+(1.048), (I-655)+(1.015)+(1.049), (I-655)+(1.015)+(1.050), (I-655)+(1.015)+(1.051), (I-655)+(1.015)+(1.052), (I-655)+(1.015)+(1.053), (I-655)+(1.015)+(1.054), (I-655)+(1.015)+(1.055), (I-655)+(1.015)+(1.056), (I-655)+(1.015)+(1.057), (I-655)+(1.015)+(1.058), (I-655)+(1.015)+(1.059), (I-655)+(1.015)+(1.060), (I-655)+(1.015)+(1.061), (I-655)+(1.015)+(1.062), (I-655)+(1.015)+(1.063), (I-655)+(1.015)+(1.064), (I-655)+(1.015)+(1.065), (I-655)+(1.015)+(1.066), (I-655)+(1.015)+(1.067), (I-655)+(1.015)+(1.068), (I-655)+(1.015)+(1.069), (I-655)+(1.015)+(1.070), (I-655)+(1.015)+(1.071), (I-655)+(1.015)+(1.072), (I-655)+(1.015)+(1.073), (I-655)+(1.015)+(1.074), (I-655)+(1.015)+(1.075), (I-655)+(1.015)+(1.076), (I-655)+(1.015)+(1.077), (I-655)+(1.015)+(1.078), (I-655)+(1.015)+(1.079), (I-655)+(1.015)+(1.080), (I-655)+(1.015)+(1.081), (I-655)+(1.015)+(1.082), (I-655)+(1.015)+(1.083), (I-655)+(1.015)+(1.084), (I-655)+(1.015)+(1.085), (I-655)+(1.015)+(1.086), (I-655)+(1.015)+(1.087), (I-655)+(1.015)+(1.088), (I-655)+(1.015)+(1.089), (I-655)+(1.015)+(1.090), (I-655)+(1.015)+(1.091), (I-655)+(1.015)+(1.092), (I-655)+(1.015)+(2.001), (I-655)+(1.015)+(2.002), (I-655)+(1.015)+(2.003), (I-655)+(1.015)+(2.004), (I-655)+(1.015)+(2.005), (I-655)+(1.015)+(2.006), (I-655)+(1.015)+(2.007), (I-655)+(1.015)+(2.008), (I-655)+(1.015)+(2.009), (I-655)+(1.015)+(2.010), (I-655)+(1.015)+(2.011), (I-655)+(1.015)+(2.012), (I-655)+(1.015)+(2.013), (I-655)+(1.015)+(2.014), (I-655)+(1.015)+(2.015), (I-655)+(1.015)+(2.016), (I-655)+(1.015)+(2.017), (I-655)+(1.015)+(2.018), (I-655)+(1.015)+(2.019), (I-655)+(1.015)+(2.020), (I-655)+(1.015)+(2.021), (I-655)+(1.015)+(2.022), (I-655)+(1.015)+(2.023), (I-655)+(1.015)+(2.024), (I-655)+(1.015)+(2.025), (I-655)+(1.015)+(2.026), (I-655)+(1.015)+(2.027), (I-655)+(1.015)+(2.028), (I-655)+(1.015)+(2.029), (I-655)+(1.015)+(2.030), (I-655)+(1.015)+(2.031), (I-655)+(1.015)+(2.032), (I-655)+(1.015)+(2.033), (I-655)+(1.015)+(2.034), (I-655)+(1.015)+(2.035), (I-655)+(1.015)+(2.036), (I-655)+(1.015)+(2.037), (I-655)+(1.015)+(2.038), (I-655)+(1.015)+(2.039), (I-655)+(1.015)+(2.040), (I-655)+(1.015)+(2.041), (I-655)+(1.015)+(2.042), (I-655)+(1.015)+(2.043), (I-655)+(1.015)+(2.044), (I-655)+(1.015)+(2.045), (I-655)+(1.015)+(2.046), (I-655)+(1.015)+(2.047), (I-655)+(1.015)+(2.048), (I-655)+(1.015)+(2.049), (I-655)+(1.015)+(2.050), (I-655)+(1.015)+(2.051), (I-655)+(1.015)+(2.052), (I-655)+(1.015)+(2.053), (I-655)+(1.015)+(2.054), (I-655)+(1.015)+(2.055), (I-655)+(1.015)+(2.056), (I-655)+(1.015)+(2.057), (I-655)+(1.015)+(2.058), (I-655)+(1.015)+(2.059), (I-655)+(1.015)+(3.001), (I-655)+(1.015)+(3.002), (I-655)+(1.015)+(3.003), (I-655)+(1.015)+(3.004), (I-655)+(1.015)+(3.005), (I-655)+(1.015)+(3.006), (I-655)+(1.015)+(3.007), (I-655)+(1.015)+(3.008), (I-655)+(1.015)+(3.009), (I-655)+(1.015)+(3.010), (I-655)+(1.015)+(3.011), (I-655)+(1.015)+(3.012), (I-655)+(1.015)+(3.013), (I-655)+(1.015)+(3.014), (I-655)+(1.015)+(3.015), (I-655)+(1.015)+(3.016), (I-655)+(1.015)+(3.017), (I-655)+(1.015)+(3.018), (I-655)+(1.015)+(3.019), (I-655)+(1.015)+(3.020), (I-655)+(1.015)+(3.021), (I-655)+(1.015)+(3.022), (I-655)+(1.015)+(3.023), (I-655)+(1.015)+(3.024), (I-655)+(1.015)+(3.025), (I-655)+(1.015)+(3.026), (I-655)+(1.015)+(3.027), (I-655)+(1.015)+(3.028), (I-655)+(1.015)+(3.029), (I-655)+(1.015)+(3.030), (I-655)+(1.015)+(3.031), (I-655)+(1.015)+(5.001), (I-655)+(1.015)+(5.002), (I-655)+(1.015)+(5.003), (I-655)+(1.015)+(5.004), (I-655)+(1.015)+(5.005), (I-655)+(1.015)+(5.006), (I-655)+(1.015)+(5.007), (I-655)+(1.015)+(5.008), (I-655)+(1.015)+(5.009), (I-655)+(1.015)+(5.010), (I-655)+(1.015)+(5.011), (I-655)+(1.015)+(5.012), (I-655)+(1.015)+(5.013), (I-655)+(1.015)+(5.014), (I-655)+(1.015)+(5.015), (I-655)+(1.015)+(5.016), (I-655)+(1.015)+(5.017), (I-655)+(1.015)+(5.018), (I-655)+(1.015)+(5.019), (I-655)+(1.015)+(5.020), (I-655)+(1.015)+(5.021), (I-655)+(1.015)+(5.022), (I-655)+(1.015)+(5.023), (I-655)+(1.015)+(6.001), (I-655)+(1.015)+(6.002), (I-655)+(1.015)+(6.003), (I-655)+(1.015)+(6.004), (I-655)+(1.015)+(7.001), (I-655)+(1.015)+(7.002), (I-655)+(1.015)+(7.003), (I-655)+(1.015)+(7.004), (I-655)+(1.015)+(7.005), (I-655)+(1.015)+(7.006), (I-655)+(1.015)+(9.001), (I-655)+(1.015)+(9.002), (I-655)+(1.015)+(9.003), (I-655)+(1.015)+(9.004), (I-655)+(1.015)+(9.005), (I-655)+(1.015)+(9.006), (I-655)+(1.015)+(9.007), (I-655)+(1.015)+(9.008), (I-655)+(1.015)+(9.009), (I-655)+(1.015)+(14.001), (I-655)+(1.015)+(14.002), (I-655)+(1.015)+(15.008), (I-655)+(1.015)+(15.011), (I-655)+(1.015)+(15.012), (I-655)+(1.015)+(15.016), (I-655)+(1.015)+(15.025), (I-655)+(1.015)+(15.027), (I-655)+(1.015)+(15.047), (I-655)+(1.015)+(15.063), (I-655)+(1.015)+(15.064), (I-655)+(1.015)+(16.001), (I-655)+(1.015)+(16.002), (I-655)+(1.015)+(16.003), (I-655)+(1.015)+(16.004), (I-655)+(1.015)+(16.005), (I-655)+(1.015)+(16.006), (I-655)+(1.015)+(16.007), (I-655)+(1.015)+(16.008), (I-655)+(1.015)+(17.001), (I-655)+(1.015)+(17.002), (I-655)+(1.015)+(17.003), (I-655)+(1.015)+(17.004), (I-655)+(1.015)+(17.005), (I-655)+(1.015)+(17.006), (I-655)+(1.015)+(17.007), (I-655)+(1.015)+(17.008), (I-655)+(1.015)+(17.009), (I-655)+(1.015)+(17.010), (I-655)+(1.015)+(17.011), (I-655)+(1.015)+(17.012), (I-655)+(1.015)+(18.001),

(I-655)+(1.016)+(1.017), (I-655)+(1.016)+(1.018), (I-655)+(1.016)+(1.019), (I-655)+(1.016)+(1.020), (I-655)+(1.016)+(1.021), (I-655)+(1.016)+(1.022), (I-655)+(1.016)+(1.023), (I-655)+(1.016)+(1.024), (I-655)+(1.016)+(1.025), (I-655)+(1.016)+(1.026), (I-655)+(1.016)+(1.027), (I-655)+(1.016)+(1.028), (I-655)+(1.016)+(1.029), (I-655)+(1.016)+(1.030), (I-655)+(1.016)+(1.031), (I-655)+(1.016)+(1.032), (I-655)+(1.016)+(1.033), (I-655)+(1.016)+(1.034), (I-655)+(1.016)+(1.035), (I-655)+(1.016)+(1.036), (I-655)+(1.016)+(1.037), (I-655)+(1.016)+(1.038), (I-655)+(1.016)+(1.039), (I-655)+(1.016)+(1.040), (I-655)+(1.016)+(1.041), (I-655)+(1.016)+(1.042), (I-655)+(1.016)+(1.043), (I-655)+(1.016)+(1.044), (I-655)+(1.016)+(1.045), (I-655)+(1.016)+(1.046), (I-655)+(1.016)+(1.047), (I-655)+(1.016)+(1.048), (I-655)+(1.016)+(1.049), (I-655)+(1.016)+(1.050), (I-655)+(1.016)+(1.051), (I-655)+(1.016)+(1.052), (I-655)+(1.016)+(1.053), (I-655)+(1.016)+(1.054), (I-655)+(1.016)+(1.055), (I-655)+(1.016)+(1.056), (I-655)+(1.016)+(1.057), (I-655)+(1.016)+(1.058), (I-655)+(1.016)+(1.059), (I-655)+(1.016)+(1.060), (I-655)+(1.016)+(1.061), (I-655)+(1.016)+(1.062), (I-655)+(1.016)+(1.063), (I-655)+(1.016)+(1.064), (I-655)+(1.016)+(1.065), (I-655)+(1.016)+(1.066), (I-655)+(1.016)+(1.067), (I-655)+(1.016)+(1.068), (I-655)+(1.016)+(1.069), (I-655)+(1.016)+(1.070), (I-655)+(1.016)+(1.071), (I-655)+(1.016)+(1.072), (I-655)+(1.016)+(1.073), (I-655)+(1.016)+(1.074), (I-655)+(1.016)+(1.075), (I-655)+(1.016)+(1.076), (I-655)+(1.016)+(1.077), (I-655)+(1.016)+(1.078), (I-655)+(1.016)+(1.079), (I-655)+(1.016)+(1.080), (I-655)+(1.016)+(1.081), (I-655)+(1.016)+(1.082), (I-655)+(1.016)+(1.083), (I-655)+(1.016)+(1.084), (I-655)+(1.016)+(1.085), (I-655)+(1.016)+(1.086), (I-655)+(1.016)+(1.087), (I-655)+(1.016)+(1.088), (I-655)+(1.016)+(1.089), (I-655)+(1.016)+(1.090), (I-655)+(1.016)+(1.091), (I-655)+(1.016)+(1.092), (I-655)+(1.016)+(2.001), (I-655)+(1.016)+(2.002), (I-655)+(1.016)+(2.003), (I-655)+(1.016)+(2.004), (I-655)+(1.016)+(2.005), (I-655)+(1.016)+(2.006), (I-655)+(1.016)+(2.007), (I-655)+(1.016)+(2.008), (I-655)+(1.016)+(2.009), (I-655)+(1.016)+(2.010), (I-655)+(1.016)+(2.011), (I-655)+(1.016)+(2.012), (I-655)+(1.016)+(2.013), (I-655)+(1.016)+(2.014), (I-655)+(1.016)+(2.015), (I-655)+(1.016)+(2.016), (I-655)+(1.016)+(2.017), (I-655)+(1.016)+(2.018), (I-655)+(1.016)+(2.019), (I-655)+(1.016)+(2.020), (I-655)+(1.016)+(2.021), (I-655)+(1.016)+(2.022), (I-655)+(1.016)+(2.023), (I-655)+(1.016)+(2.024), (I-655)+(1.016)+(2.025), (I-655)+(1.016)+(2.026), (I-655)+(1.016)+(2.027), (I-655)+(1.016)+(2.028), (I-655)+(1.016)+(2.029), (I-655)+(1.016)+(2.030), (I-655)+(1.016)+(2.031), (I-655)+(1.016)+(2.032), (I-655)+(1.016)+(2.033), (I-655)+(1.016)+(2.034), (I-655)+(1.016)+(2.035), (I-655)+(1.016)+(2.036), (I-655)+(1.016)+(2.037), (I-655)+(1.016)+(2.038), (I-655)+(1.016)+(2.039), (I-655)+(1.016)+(2.040), (I-655)+(1.016)+(2.041), (I-655)+(1.016)+(2.042), (I-655)+(1.016)+(2.043), (I-655)+(1.016)+(2.044), (I-655)+(1.016)+(2.045), (I-655)+(1.016)+(2.046), (I-655)+(1.016)+(2.047), (I-655)+(1.016)+(2.048), (I-655)+(1.016)+(2.049), (I-655)+(1.016)+(2.050), (I-655)+(1.016)+(2.051), (I-655)+(1.016)+(2.052), (I-655)+(1.016)+(2.053), (I-655)+(1.016)+(2.054), (I-655)+(1.016)+(2.055), (I-655)+(1.016)+(2.056), (I-655)+(1.016)+(2.057), (I-655)+(1.016)+(2.058), (I-655)+(1.016)+(2.059), (I-655)+(1.016)+(3.001), (I-655)+(1.016)+(3.002), (I-655)+(1.016)+(3.003), (I-655)+(1.016)+(3.004), (I-655)+(1.016)+(3.005), (I-655)+(1.016)+(3.006), (I-655)+(1.016)+(3.007), (I-655)+(1.016)+(3.008), (I-655)+(1.016)+(3.009), (I-655)+(1.016)+(3.010), (I-655)+(1.016)+(3.011), (I-655)+(1.016)+(3.012), (I-655)+(1.016)+(3.013), (I-655)+(1.016)+(3.014), (I-655)+(1.016)+(3.015), (I-655)+(1.016)+(3.016), (I-655)+(1.016)+(3.017), (I-655)+(1.016)+(3.018), (I-655)+(1.016)+(3.019), (I-655)+(1.016)+(3.020), (I-655)+(1.016)+(3.021), (I-655)+(1.016)+(3.022), (I-655)+(1.016)+(3.023), (I-655)+(1.016)+(3.024), (I-655)+(1.016)+(3.025), (I-655)+(1.016)+(3.026), (I-655)+(1.016)+(3.027), (I-655)+(1.016)+(3.028), (I-655)+(1.016)+(3.029), (I-655)+(1.016)+(3.030), (I-655)+(1.016)+(3.031), (I-655)+(1.016)+(5.001), (I-655)+(1.016)+(5.002), (I-655)+(1.016)+(5.003), (I-655)+(1.016)+(5.004), (I-655)+(1.016)+(5.005), (I-655)+(1.016)+(5.006), (I-655)+(1.016)+(5.007), (I-655)+(1.016)+(5.008), (I-655)+(1.016)+(5.009), (I-655)+(1.016)+(5.010), (I-655)+(1.016)+(5.011), (I-655)+(1.016)+(5.012), (I-655)+(1.016)+(5.013), (I-655)+(1.016)+(5.014), (I-655)+(1.016)+(5.015), (I-655)+(1.016)+(5.016), (I-655)+(1.016)+(5.017), (I-655)+(1.016)+(5.018), (I-655)+(1.016)+(5.019), (I-655)+(1.016)+(5.020), (I-655)+(1.016)+(5.021), (I-655)+(1.016)+(5.022), (I-655)+(1.016)+(5.023), (I-655)+(1.016)+(6.001), (I-655)+(1.016)+(6.002), (I-655)+(1.016)+(6.003), (I-655)+(1.016)+(6.004), (I-655)+(1.016)+(7.001), (I-655)+(1.016)+(7.002), (I-655)+(1.016)+(7.003), (I-655)+(1.016)+(7.004), (I-655)+(1.016)+(7.005), (I-655)+(1.016)+(7.006), (I-655)+(1.016)+(9.001), (I-655)+(1.016)+(9.002), (I-655)+(1.016)+(9.003), (I-655)+(1.016)+(9.004), (I-655)+(1.016)+(9.005), (I-655)+(1.016)+(9.006), (I-655)+(1.016)+(9.007), (I-655)+(1.016)+(9.008), (I-655)+(1.016)+(9.009), (I-655)+(1.016)+(14.001), (I-655)+(1.016)+(14.002), (I-655)+(1.016)+(15.008), (I-655)+(1.016)+(15.011), (I-655)+(1.016)+(15.012), (I-655)+(1.016)+(15.016), (I-655)+(1.016)+(15.025), (I-655)+(1.016)+(15.027), (I-655)+(1.016)+(15.047), (I-655)+(1.016)+(15.063), (I-655)+(1.016)+(15.064), (I-655)+(1.016)+(16.001), (I-655)+(1.016)+(16.002), (I-655)+(1.016)+(16.003), (I-655)+(1.016)+(16.004), (I-655)+(1.016)+(16.005), (I-655)+(1.016)+(16.006), (I-655)+(1.016)+(16.007), (I-655)+(1.016)+(16.008), (I-655)+(1.016)+(17.001), (I-655)+(1.016)+(17.002), (I-655)+(1.016)+(17.003), (I-655)+(1.016)+(17.004), (I-655)+(1.016)+(17.005), (I-655)+(1.016)+(17.006), (I-655)+(1.016)+(17.007), (I-655)+(1.016)+(17.008), (I-655)+(1.016)+(17.009), (I-655)+(1.016)+(17.010), (I-655)+(1.016)+(17.011), (I-655)+(1.016)+(17.012), (I-655)+(1.016)+(18.001),

(I-655)+(1.017)+(1.018), (I-655)+(1.017)+(1.019), (I-655)+(1.017)+(1.020), (I-655)+(1.017)+(1.021), (I-655)+(1.017)+(1.022), (I-655)+(1.017)+(1.023), (I-655)+(1.017)+(1.024), (I-655)+(1.017)+(1.025), (I-655)+(1.017)+(1.026), (I-655)+(1.017)+(1.027), (I-655)+(1.017)+(1.028), (I-655)+(1.017)+(1.029), (I-655)+(1.017)+(1.030), (I-655)+(1.017)+(1.031), (I-655)+(1.017)+(1.032), (I-655)+(1.017)+(1.033), (I-655)+(1.017)+(1.034), (I-655)+(1.017)+(1.035), (I-655)+(1.017)+(1.036), (I-655)+(1.017)+(1.037), (I-655)+(1.017)+(1.038), (I-655)+(1.017)+(1.039), (I-655)+(1.017)+(1.040), (I-655)+(1.017)+(1.041), (I-655)+(1.017)+(1.042), (I-655)+(1.017)+(1.043), (I-655)+(1.017)+(1.044), (I-655)+(1.017)+(1.045), (I-655)+(1.017)+(1.046), (I-655)+(1.017)+(1.047), (I-655)+(1.017)+(1.048), (I-655)+(1.017)+(1.049), (I-655)+(1.017)+(1.050), (I-655)+(1.017)+(1.051), (I-655)+(1.017)+(1.052), (I-655)+(1.017)+(1.053), (I-655)+(1.017)+(1.054), (I-655)+(1.017)+(1.055), (I-655)+(1.017)+(1.056), (I-655)+(1.017)+(1.057), (I-655)+(1.017)+(1.058), (I-655)+(1.017)+(1.059), (I-655)+(1.017)+(1.060), (I-655)+(1.017)+(1.061), (I-655)+(1.017)+(1.062), (I-655)+(1.017)+(1.063), (I-655)+(1.017)+(1.064), (I-655)+(1.017)+(1.065), (I-655)+(1.017)+(1.066), (I-655)+(1.017)+(1.067), (I-655)+(1.017)+(1.068), (I-655)+(1.017)+(1.069), (I-655)+(1.017)+(1.070), (I-655)+(1.017)+(1.071), (I-655)+(1.017)+(1.072), (I-655)+(1.017)+(1.073), (I-655)+(1.017)+(1.074), (I-655)+(1.017)+(1.075), (I-655)+(1.017)+(1.076), (I-655)+(1.017)+(1.077), (I-655)+(1.017)+(1.078), (I-655)+(1.017)+(1.079), (I-655)+(1.017)+(1.080), (I-655)+(1.017)+(1.081), (I-655)+(1.017)+(1.082), (I-655)+(1.017)+(1.083), (I-655)+(1.017)+(1.084), (I-655)+(1.017)+(1.085), (I-655)+(1.017)+(1.086), (I-655)+(1.017)+(1.087), (I-655)+(1.017)+(1.088), (I-655)+(1.017)+(1.089), (I-655)+(1.017)+(1.090), (I-655)+(1.017)+(1.091), (I-655)+(1.017)+(1.092), (I-655)+(1.017)+(2.001), (I-655)+(1.017)+(2.002), (I-655)+(1.017)+(2.003), (I-655)+(1.017)+(2.004), (I-655)+(1.017)+(2.005), (I-655)+(1.017)+(2.006), (I-655)+(1.017)+(2.007), (I-655)+(1.017)+(2.008), (I-655)+(1.017)+(2.009), (I-655)+(1.017)+(2.010), (I-655)+(1.017)+(2.011), (I-655)+(1.017)+(2.012), (I-655)+(1.017)+(2.013), (I-655)+(1.017)+(2.014), (I-655)+(1.017)+(2.015), (I-655)+(1.017)+(2.016), (I-655)+(1.017)+(2.017), (I-655)+(1.017)+(2.018), (I-655)+(1.017)+(2.019), (I-655)+(1.017)+(2.020), (I-655)+(1.017)+(2.021), (I-655)+(1.017)+(2.022), (I-655)+(1.017)+(2.023), (I-655)+(1.017)+(2.024), (I-655)+(1.017)+(2.025), (I-655)+(1.017)+(2.026), (I-655)+(1.017)+(2.027), (I-655)+(1.017)+(2.028), (I-655)+(1.017)+(2.029), (I-655)+(1.017)+(2.030), (I-655)+(1.017)+(2.031), (I-655)+(1.017)+(2.032), (I-655)+(1.017)+(2.033), (I-655)+(1.017)+(2.034), (I-655)+(1.017)+(2.035), (I-655)+(1.017)+(2.036), (I-655)+(1.017)+(2.037), (I-655)+(1.017)+(2.038), (I-655)+(1.017)+(2.039), (I-655)+(1.017)+(2.040), (I-655)+(1.017)+(2.041), (I-655)+(1.017)+(2.042), (I-655)+(1.017)+(2.043), (I-655)+(1.017)+(2.044), (I-655)+(1.017)+(2.045), (I-655)+(1.017)+(2.046), (I-655)+(1.017)+(2.047), (I-655)+(1.017)+(2.048), (I-655)+(1.017)+(2.049), (I-655)+(1.017)+(2.050), (I-655)+(1.017)+(2.051), (I-655)+(1.017)+(2.052), (I-655)+(1.017)+(2.053), (I-655)+(1.017)+(2.054), (I-655)+(1.017)+(2.055), (I-655)+(1.017)+(2.056), (I-655)+(1.017)+(2.057), (I-655)+(1.017)+(2.058), (I-655)+(1.017)+(2.059), (I-655)+(1.017)+(3.001), (I-655)+(1.017)+(3.002), (I-655)+(1.017)+(3.003), (I-655)+(1.017)+(3.004), (I-655)+(1.017)+(3.005), (I-655)+(1.017)+(3.006), (I-655)+(1.017)+(3.007), (I-655)+(1.017)+(3.008), (I-655)+(1.017)+(3.009), (I-655)+(1.017)+(3.010), (I-655)+(1.017)+(3.011), (I-655)+(1.017)+(3.012), (I-655)+(1.017)+(3.013), (I-655)+(1.017)+(3.014), (I-655)+(1.017)+(3.015), (I-655)+(1.017)+(3.016), (I-655)+(1.017)+(3.017), (I-655)+(1.017)+(3.018), (I-655)+(1.017)+(3.019), (I-655)+(1.017)+(3.020), (I-655)+(1.017)+(3.021), (I-655)+(1.017)+(3.022), (I-655)+(1.017)+(3.023), (I-655)+(1.017)+(3.024), (I-655)+(1.017)+(3.025), (I-655)+(1.017)+(3.026), (I-655)+(1.017)+(3.027), (I-655)+(1.017)+(3.028), (I-655)+(1.017)+(3.029), (I-655)+(1.017)+(3.030), (I-655)+(1.017)+(3.031), (I-655)+(1.017)+(5.001), (I-655)+(1.017)+(5.002), (I-655)+(1.017)+(5.003), (I-655)+(1.017)+(5.004), (I-655)+(1.017)+(5.005), (I-655)+(1.017)+(5.006), (I-655)+(1.017)+(5.007), (I-655)+(1.017)+(5.008), (I-655)+(1.017)+(5.009), (I-655)+(1.017)+(5.010), (I-655)+(1.017)+(5.011), (I-655)+(1.017)+(5.012), (I-655)+(1.017)+(5.013), (I-655)+(1.017)+(5.014), (I-655)+(1.017)+(5.015), (I-655)+(1.017)+(5.016), (I-655)+(1.017)+(5.017), (I-655)+(1.017)+(5.018), (I-655)+(1.017)+(5.019), (I-655)+(1.017)+(5.020), (I-655)+(1.017)+(5.021), (I-655)+(1.017)+(5.022), (I-655)+(1.017)+(5.023), (I-655)+(1.017)+(6.001), (I-655)+(1.017)+(6.002), (I-655)+(1.017)+(6.003), (I-655)+(1.017)+(6.004), (I-655)+(1.017)+(7.001), (I-655)+(1.017)+(7.002), (I-655)+(1.017)+(7.003), (I-655)+(1.017)+(7.004), (I-655)+(1.017)+(7.005), (I-655)+(1.017)+(7.006), (I-655)+(1.017)+(9.001), (I-655)+(1.017)+(9.002), (I-655)+(1.017)+(9.003), (I-655)+(1.017)+(9.004), (I-655)+(1.017)+(9.005), (I-655)+(1.017)+(9.006), (I-655)+(1.017)+(9.007), (I-655)+(1.017)+(9.008), (I-655)+(1.017)+(9.009), (I-655)+(1.017)+(14.001), (I-655)+(1.017)+(14.002), (I-655)+(1.017)+(15.008), (I-655)+(1.017)+(15.011), (I-655)+(1.017)+(15.012), (I-655)+(1.017)+(15.016), (I-655)+(1.017)+(15.025), (I-655)+(1.017)+(15.027), (I-655)+(1.017)+(15.047), (I-655)+(1.017)+(15.063), (I-655)+(1.017)+(15.064), (I-655)+(1.017)+(16.001), (I-655)+(1.017)+(16.002), (I-655)+(1.017)+(16.003), (I-655)+(1.017)+(16.004), (I-655)+(1.017)+(16.005), (I-655)+(1.017)+(16.006), (I-655)+(1.017)+(16.007), (I-655)+(1.017)+(16.008), (I-655)+(1.017)+(17.001), (I-655)+(1.017)+(17.002), (I-655)+(1.017)+(17.003), (I-655)+(1.017)+(17.004), (I-655)+(1.017)+(17.005), (I-655)+(1.017)+(17.006), (I-655)+(1.017)+(17.007), (I-655)+(1.017)+(17.008), (I-655)+(1.017)+(17.009), (I-655)+(1.017)+(17.010), (I-655)+(1.017)+(17.011), (I-655)+(1.017)+(17.012), (I-655)+(1.017)+(18.001),

(I-655)+(1.018)+(1.019), (I-655)+(1.018)+(1.020), (I-655)+(1.018)+(1.021), (I-655)+(1.018)+(1.022), (I-655)+(1.018)+(1.023), (I-655)+(1.018)+(1.024), (I-655)+(1.018)+(1.025), (I-655)+(1.018)+(1.026), (I-655)+(1.018)+(1.027), (I-655)+(1.018)+(1.028), (I-655)+(1.018)+(1.029), (I-655)+(1.018)+(1.030), (I-655)+(1.018)+(1.031), (I-655)+(1.018)+(1.032), (I-655)+(1.018)+(1.033), (I-655)+(1.018)+(1.034), (I-655)+(1.018)+(1.035), (I-655)+(1.018)+(1.036), (I-655)+(1.018)+(1.037), (I-655)+(1.018)+(1.038), (I-655)+(1.018)+(1.039), (I-655)+(1.018)+(1.040), (I-655)+(1.018)+(1.041), (I-655)+(1.018)+(1.042), (I-655)+(1.018)+(1.043), (I-655)+(1.018)+(1.044), (I-655)+(1.018)+(1.045), (I-655)+(1.018)+(1.046), (I-655)+(1.018)+(1.047), (I-655)+(1.018)+(1.048), (I-655)+(1.018)+(1.049), (I-655)+(1.018)+(1.050), (I-655)+(1.018)+(1.051), (I-655)+(1.018)+(1.052), (I-655)+(1.018)+(1.053), (I-655)+(1.018)+(1.054), (I-655)+(1.018)+(1.055), (I-655)+(1.018)+(1.056), (I-655)+(1.018)+(1.057), (I-655)+(1.018)+(1.058), (I-655)+(1.018)+(1.059), (I-655)+(1.018)+(1.060), (I-655)+(1.018)+(1.061), (I-655)+(1.018)+(1.062), (I-655)+(1.018)+(1.063), (I-655)+(1.018)+(1.064), (I-655)+(1.018)+(1.065), (I-655)+(1.018)+(1.066), (I-655)+(1.018)+(1.067), (I-655)+(1.018)+(1.068), (I-655)+(1.018)+(1.069), (I-655)+(1.018)+(1.070), (I-655)+(1.018)+(1.071), (I-655)+(1.018)+(1.072), (I-655)+(1.018)+(1.073), (I-655)+(1.018)+(1.074), (I-655)+(1.018)+(1.075), (I-655)+(1.018)+(1.076), (I-655)+(1.018)+(1.077), (I-655)+(1.018)+(1.078), (I-655)+(1.018)+(1.079), (I-655)+(1.018)+(1.080), (I-655)+(1.018)+(1.081), (I-655)+(1.018)+(1.082), (I-655)+(1.018)+(1.083), (I-655)+(1.018)+(1.084), (I-655)+(1.018)+(1.085), (I-655)+(1.018)+(1.086), (I-655)+(1.018)+(1.087), (I-655)+(1.018)+(1.088), (I-655)+(1.018)+(1.089), (I-655)+(1.018)+(1.090), (I-655)+(1.018)+(1.091), (I-655)+(1.018)+(1.092), (I-655)+(1.018)+(2.001), (I-655)+(1.018)+(2.002), (I-655)+(1.018)+(2.003), (I-655)+(1.018)+(2.004), (I-655)+(1.018)+(2.005), (I-655)+(1.018)+(2.006), (I-655)+(1.018)+(2.007), (I-655)+(1.018)+(2.008), (I-655)+(1.018)+(2.009), (I-655)+(1.018)+(2.010), (I-655)+(1.018)+(2.011), (I-655)+(1.018)+(2.012), (I-655)+(1.018)+(2.013), (I-655)+(1.018)+(2.014), (I-655)+(1.018)+(2.015), (I-655)+(1.018)+(2.016), (I-655)+(1.018)+(2.017), (I-655)+(1.018)+(2.018), (I-655)+(1.018)+(2.019), (I-655)+(1.018)+(2.020), (I-655)+(1.018)+(2.021), (I-655)+(1.018)+(2.022), (I-655)+(1.018)+(2.023), (I-655)+(1.018)+(2.024), (I-655)+(1.018)+(2.025), (I-655)+(1.018)+(2.026), (I-655)+(1.018)+(2.027), (I-655)+(1.018)+(2.028), (I-655)+(1.018)+(2.029), (I-655)+(1.018)+(2.030), (I-655)+(1.018)+(2.031), (I-655)+(1.018)+(2.032), (I-655)+(1.018)+(2.033), (I-655)+(1.018)+(2.034), (I-655)+(1.018)+(2.035), (I-655)+(1.018)+(2.036), (I-655)+(1.018)+(2.037), (I-655)+(1.018)+(2.038), (I-655)+(1.018)+(2.039), (I-655)+(1.018)+(2.040), (I-655)+(1.018)+(2.041), (I-655)+(1.018)+(2.042), (I-655)+(1.018)+(2.043), (I-655)+(1.018)+(2.044), (I-655)+(1.018)+(2.045), (I-655)+(1.018)+(2.046), (I-655)+(1.018)+(2.047), (I-655)+(1.018)+(2.048), (I-655)+(1.018)+(2.049), (I-655)+(1.018)+(2.050), (I-655)+(1.018)+(2.051), (I-655)+(1.018)+(2.052), (I-655)+(1.018)+(2.053), (I-655)+(1.018)+(2.054), (I-655)+(1.018)+(2.055), (I-655)+(1.018)+(2.056), (I-655)+(1.018)+(2.057), (I-655)+(1.018)+(2.058), (I-655)+(1.018)+(2.059), (I-655)+(1.018)+(3.001), (I-655)+(1.018)+(3.002), (I-655)+(1.018)+(3.003), (I-655)+(1.018)+(3.004), (I-655)+(1.018)+(3.005), (I-655)+(1.018)+(3.006), (I-655)+(1.018)+(3.007), (I-655)+(1.018)+(3.008), (I-655)+(1.018)+(3.009), (I-655)+(1.018)+(3.010), (I-655)+(1.018)+(3.011), (I-655)+(1.018)+(3.012), (I-655)+(1.018)+(3.013), (I-655)+(1.018)+(3.014), (I-655)+(1.018)+(3.015), (I-655)+(1.018)+(3.016), (I-655)+(1.018)+(3.017), (I-655)+(1.018)+(3.018), (I-655)+(1.018)+(3.019), (I-655)+(1.018)+(3.020), (I-655)+(1.018)+(3.021), (I-655)+(1.018)+(3.022), (I-655)+(1.018)+(3.023), (I-655)+(1.018)+(3.024), (I-655)+(1.018)+(3.025), (I-655)+(1.018)+(3.026), (I-655)+(1.018)+(3.027), (I-655)+(1.018)+(3.028), (I-655)+(1.018)+(3.029), (I-655)+(1.018)+(3.030), (I-655)+(1.018)+(3.031), (I-655)+(1.018)+(5.001), (I-655)+(1.018)+(5.002), (I-655)+(1.018)+(5.003), (I-655)+(1.018)+(5.004), (I-655)+(1.018)+(5.005), (I-655)+(1.018)+(5.006), (I-655)+(1.018)+(5.007), (I-655)+(1.018)+(5.008), (I-655)+(1.018)+(5.009), (I-655)+(1.018)+(5.010), (I-655)+(1.018)+(5.011), (I-655)+(1.018)+(5.012), (I-655)+(1.018)+(5.013), (I-655)+(1.018)+(5.014), (I-655)+(1.018)+(5.015), (I-655)+(1.018)+(5.016), (I-655)+(1.018)+(5.017), (I-655)+(1.018)+(5.018), (I-655)+(1.018)+(5.019), (I-655)+(1.018)+(5.020), (I-655)+(1.018)+(5.021), (I-655)+(1.018)+(5.022), (I-655)+(1.018)+(5.023), (I-655)+(1.018)+(6.001), (I-655)+(1.018)+(6.002), (I-655)+(1.018)+(6.003), (I-655)+(1.018)+(6.004), (I-655)+(1.018)+(7.001), (I-655)+(1.018)+(7.002), (I-655)+(1.018)+(7.003), (I-655)+(1.018)+(7.004), (I-655)+(1.018)+(7.005), (I-655)+(1.018)+(7.006), (I-655)+(1.018)+(9.001), (I-655)+(1.018)+(9.002), (I-655)+(1.018)+(9.003), (I-655)+(1.018)+(9.004), (I-655)+(1.018)+(9.005), (I-655)+(1.018)+(9.006), (I-655)+(1.018)+(9.007), (I-655)+(1.018)+(9.008), (I-655)+(1.018)+(9.009), (I-655)+(1.018)+(14.001), (I-655)+(1.018)+(14.002), (I-655)+(1.018)+(15.008), (I-655)+(1.018)+(15.011), (I-655)+(1.018)+(15.012), (I-655)+(1.018)+(15.016), (I-655)+(1.018)+(15.025), (I-655)+(1.018)+(15.027), (I-655)+(1.018)+(15.047), (I-655)+(1.018)+(15.063), (I-655)+(1.018)+(15.064), (I-655)+(1.018)+(16.001), (I-655)+(1.018)+(16.002), (I-655)+(1.018)+(16.003), (I-655)+(1.018)+(16.004), (I-655)+(1.018)+(16.005), (I-655)+(1.018)+(16.006), (I-655)+(1.018)+(16.007), (I-655)+(1.018)+(16.008), (I-655)+(1.018)+(17.001), (I-655)+(1.018)+(17.002), (I-655)+(1.018)+(17.003), (I-655)+(1.018)+(17.004), (I-655)+(1.018)+(17.005), (I-655)+(1.018)+(17.006), (I-655)+(1.018)+(17.007), (I-655)+(1.018)+(17.008), (I-655)+(1.018)+(17.009), (I-655)+(1.018)+(17.010), (I-655)+(1.018)+(17.011), (I-655)+(1.018)+(17.012), (I-655)+(1.018)+(18.001),

(I-655)+(1.019)+(1.020), (I-655)+(1.019)+(1.021), (I-655)+(1.019)+(1.022), (I-655)+(1.019)+(1.023), (I-655)+(1.019)+(1.024), (I-655)+(1.019)+(1.025), (I-655)+(1.019)+(1.026), (I-655)+(1.019)+(1.027), (I-655)+(1.019)+(1.028), (I-655)+(1.019)+(1.029), (I-655)+(1.019)+(1.030), (I-655)+(1.019)+(1.031), (I-655)+(1.019)+(1.032), (I-655)+(1.019)+(1.033), (I-655)+(1.019)+(1.034), (I-655)+(1.019)+(1.035), (I-655)+(1.019)+(1.036), (I-655)+(1.019)+(1.037), (I-655)+(1.019)+(1.038), (I-655)+(1.019)+(1.039), (I-655)+(1.019)+(1.040), (I-655)+(1.019)+(1.041), (I-655)+(1.019)+(1.042), (I-655)+(1.019)+(1.043), (I-655)+(1.019)+(1.044), (I-655)+(1.019)+(1.045), (I-655)+(1.019)+(1.046), (I-655)+(1.019)+(1.047), (I-655)+(1.019)+(1.048), (I-655)+(1.019)+(1.049), (I-655)+(1.019)+(1.050), (I-655)+(1.019)+(1.051), (I-655)+(1.019)+(1.052), (I-655)+(1.019)+(1.053), (I-655)+(1.019)+(1.054), (I-655)+(1.019)+(1.055), (I-655)+(1.019)+(1.056), (I-655)+(1.019)+(1.057), (I-655)+(1.019)+(1.058), (I-655)+(1.019)+(1.059), (I-655)+(1.019)+(1.060), (I-655)+(1.019)+(1.061), (I-655)+(1.019)+(1.062), (I-655)+(1.019)+(1.063), (I-655)+(1.019)+(1.064), (I-655)+(1.019)+(1.065), (I-655)+(1.019)+(1.066), (I-655)+(1.019)+(1.067), (I-655)+(1.019)+(1.068), (I-655)+(1.019)+(1.069), (I-655)+(1.019)+(1.070), (I-655)+(1.019)+(1.071), (I-655)+(1.019)+(1.072), (I-655)+(1.019)+(1.073), (I-655)+(1.019)+(1.074), (I-655)+(1.019)+(1.075), (I-655)+(1.019)+(1.076), (I-655)+(1.019)+(1.077), (I-655)+(1.019)+(1.078), (I-655)+(1.019)+(1.079), (I-655)+(1.019)+(1.080), (I-655)+(1.019)+(1.081), (I-655)+(1.019)+(1.082), (I-655)+(1.019)+(1.083), (I-655)+(1.019)+(1.084), (I-655)+(1.019)+(1.085), (I-655)+(1.019)+(1.086), (I-655)+(1.019)+(1.087), (I-655)+(1.019)+(1.088), (I-655)+(1.019)+(1.089), (I-655)+(1.019)+(1.090), (I-655)+(1.019)+(1.091), (I-655)+(1.019)+(1.092), (I-655)+(1.019)+(2.001), (I-655)+(1.019)+(2.002), (I-655)+(1.019)+(2.003), (I-655)+(1.019)+(2.004), (I-655)+(1.019)+(2.005), (I-655)+(1.019)+(2.006), (I-655)+(1.019)+(2.007), (I-655)+(1.019)+(2.008), (I-655)+(1.019)+(2.009), (I-655)+(1.019)+(2.010), (I-655)+(1.019)+(2.011), (I-655)+(1.019)+(2.012), (I-655)+(1.019)+(2.013), (I-655)+(1.019)+(2.014), (I-655)+(1.019)+(2.015), (I-655)+(1.019)+(2.016), (I-655)+(1.019)+(2.017), (I-655)+(1.019)+(2.018), (I-655)+(1.019)+(2.019), (I-655)+(1.019)+(2.020), (I-655)+(1.019)+(2.021), (I-655)+(1.019)+(2.022), (I-655)+(1.019)+(2.023), (I-655)+(1.019)+(2.024), (I-655)+(1.019)+(2.025), (I-655)+(1.019)+(2.026), (I-655)+(1.019)+(2.027), (I-655)+(1.019)+(2.028), (I-655)+(1.019)+(2.029), (I-655)+(1.019)+(2.030), (I-655)+(1.019)+(2.031), (I-655)+(1.019)+(2.032), (I-655)+(1.019)+(2.033), (I-655)+(1.019)+(2.034), (I-655)+(1.019)+(2.035), (I-655)+(1.019)+(2.036), (I-655)+(1.019)+(2.037), (I-655)+(1.019)+(2.038), (I-655)+(1.019)+(2.039), (I-655)+(1.019)+(2.040), (I-655)+(1.019)+(2.041), (I-655)+(1.019)+(2.042), (I-655)+(1.019)+(2.043), (I-655)+(1.019)+(2.044), (I-655)+(1.019)+(2.045), (I-655)+(1.019)+(2.046), (I-655)+(1.019)+(2.047), (I-655)+(1.019)+(2.048), (I-655)+(1.019)+(2.049), (I-655)+(1.019)+(2.050), (I-655)+(1.019)+(2.051), (I-655)+(1.019)+(2.052), (I-655)+(1.019)+(2.053), (I-655)+(1.019)+(2.054), (I-655)+(1.019)+(2.055), (I-655)+(1.019)+(2.056), (I-655)+(1.019)+(2.057), (I-655)+(1.019)+(2.058), (I-655)+(1.019)+(2.059), (I-655)+(1.019)+(3.001), (I-655)+(1.019)+(3.002), (I-655)+(1.019)+(3.003), (I-655)+(1.019)+(3.004), (I-655)+(1.019)+(3.005), (I-655)+(1.019)+(3.006), (I-655)+(1.019)+(3.007), (I-655)+(1.019)+(3.008), (I-655)+(1.019)+(3.009), (I-655)+(1.019)+(3.010), (I-655)+(1.019)+(3.011), (I-655)+(1.019)+(3.012), (I-655)+(1.019)+(3.013), (I-655)+(1.019)+(3.014), (I-655)+(1.019)+(3.015), (I-655)+(1.019)+(3.016), (I-655)+(1.019)+(3.017), (I-655)+(1.019)+(3.018), (I-655)+(1.019)+(3.019), (I-655)+(1.019)+(3.020), (I-655)+(1.019)+(3.021), (I-655)+(1.019)+(3.022), (I-655)+(1.019)+(3.023), (I-655)+(1.019)+(3.024), (I-655)+(1.019)+(3.025), (I-655)+(1.019)+(3.026), (I-655)+(1.019)+(3.027), (I-655)+(1.019)+(3.028), (I-655)+(1.019)+(3.029), (I-655)+(1.019)+(3.030), (I-655)+(1.019)+(3.031), (I-655)+(1.019)+(5.001), (I-655)+(1.019)+(5.002), (I-655)+(1.019)+(5.003), (I-655)+(1.019)+(5.004), (I-655)+(1.019)+(5.005), (I-655)+(1.019)+(5.006), (I-655)+(1.019)+(5.007), (I-655)+(1.019)+(5.008), (I-655)+(1.019)+(5.009), (I-655)+(1.019)+(5.010), (I-655)+(1.019)+(5.011), (I-655)+(1.019)+(5.012), (I-655)+(1.019)+(5.013), (I-655)+(1.019)+(5.014), (I-655)+(1.019)+(5.015), (I-655)+(1.019)+(5.016), (I-655)+(1.019)+(5.017), (I-655)+(1.019)+(5.018), (I-655)+(1.019)+(5.019), (I-655)+(1.019)+(5.020), (I-655)+(1.019)+(5.021), (I-655)+(1.019)+(5.022), (I-655)+(1.019)+(5.023), (I-655)+(1.019)+(6.001), (I-655)+(1.019)+(6.002), (I-655)+(1.019)+(6.003), (I-655)+(1.019)+(6.004), (I-655)+(1.019)+(7.001), (I-655)+(1.019)+(7.002), (I-655)+(1.019)+(7.003), (I-655)+(1.019)+(7.004), (I-655)+(1.019)+(7.005), (I-655)+(1.019)+(7.006), (I-655)+(1.019)+(9.001), (I-655)+(1.019)+(9.002), (I-655)+(1.019)+(9.003), (I-655)+(1.019)+(9.004), (I-655)+(1.019)+(9.005), (I-655)+(1.019)+(9.006), (I-655)+(1.019)+(9.007), (I-655)+(1.019)+(9.008), (I-655)+(1.019)+(9.009), (I-655)+(1.019)+(14.001), (I-655)+(1.019)+(14.002), (I-655)+(1.019)+(15.008), (I-655)+(1.019)+(15.011), (I-655)+(1.019)+(15.012), (I-655)+(1.019)+(15.016), (I-655)+(1.019)+(15.025), (I-655)+(1.019)+(15.027), (I-655)+(1.019)+(15.047), (I-655)+(1.019)+(15.063), (I-655)+(1.019)+(15.064), (I-655)+(1.019)+(16.001), (I-655)+(1.019)+(16.002), (I-655)+(1.019)+(16.003), (I-655)+(1.019)+(16.004), (I-655)+(1.019)+(16.005), (I-655)+(1.019)+(16.006), (I-655)+(1.019)+(16.007), (I-655)+(1.019)+(16.008), (I-655)+(1.019)+(17.001), (I-655)+(1.019)+(17.002), (I-655)+(1.019)+(17.003), (I-655)+(1.019)+(17.004), (I-655)+(1.019)+(17.005), (I-655)+(1.019)+(17.006), (I-655)+(1.019)+(17.007), (I-655)+(1.019)+(17.008), (I-655)+(1.019)+(17.009), (I-655)+(1.019)+(17.010), (I-655)+(1.019)+(17.011), (I-655)+(1.019)+(17.012), (I-655)+(1.019)+(18.001),

(I-655)+(1.020)+(1.021), (I-655)+(1.020)+(1.022), (I-655)+(1.020)+(1.023), (I-655)+(1.020)+(1.024), (I-655)+(1.020)+(1.025), (I-655)+(1.020)+(1.026), (I-655)+(1.020)+(1.027), (I-655)+(1.020)+(1.028), (I-655)+(1.020)+(1.029), (I-655)+(1.020)+(1.030), (I-655)+(1.020)+(1.031), (I-655)+(1.020)+(1.032), (I-655)+(1.020)+(1.033), (I-655)+(1.020)+(1.034), (I-655)+(1.020)+(1.035), (I-655)+(1.020)+(1.036), (I-655)+(1.020)+(1.037), (I-655)+(1.020)+(1.038), (I-655)+(1.020)+(1.039), (I-655)+(1.020)+(1.040), (I-655)+(1.020)+(1.041), (I-655)+(1.020)+(1.042), (I-655)+(1.020)+(1.043), (I-655)+(1.020)+(1.044), (I-655)+(1.020)+(1.045), (I-655)+(1.020)+(1.046), (I-655)+(1.020)+(1.047), (I-655)+(1.020)+(1.048), (I-655)+(1.020)+(1.049), (I-655)+(1.020)+(1.050), (I-655)+(1.020)+(1.051), (I-655)+(1.020)+(1.052), (I-655)+(1.020)+(1.053), (I-655)+(1.020)+(1.054), (I-655)+(1.020)+(1.055), (I-655)+(1.020)+(1.056), (I-655)+(1.020)+(1.057), (I-655)+(1.020)+(1.058), (I-655)+(1.020)+(1.059), (I-655)+(1.020)+(1.060), (I-655)+(1.020)+(1.061), (I-655)+(1.020)+(1.062), (I-655)+(1.020)+(1.063), (I-655)+(1.020)+(1.064), (I-655)+(1.020)+(1.065), (I-655)+(1.020)+(1.066), (I-655)+(1.020)+(1.067), (I-655)+(1.020)+(1.068), (I-655)+(1.020)+(1.069), (I-655)+(1.020)+(1.070), (I-655)+(1.020)+(1.071), (I-655)+(1.020)+(1.072), (I-655)+(1.020)+(1.073), (I-655)+(1.020)+(1.074), (I-655)+(1.020)+(1.075), (I-655)+(1.020)+(1.076), (I-655)+(1.020)+(1.077), (I-655)+(1.020)+(1.078), (I-655)+(1.020)+(1.079), (I-655)+(1.020)+(1.080), (I-655)+(1.020)+(1.081), (I-655)+(1.020)+(1.082), (I-655)+(1.020)+(1.083), (I-655)+(1.020)+(1.084), (I-655)+(1.020)+(1.085), (I-655)+(1.020)+(1.086), (I-655)+(1.020)+(1.087), (I-655)+(1.020)+(1.088), (I-655)+(1.020)+(1.089), (I-655)+(1.020)+(1.090), (I-655)+(1.020)+(1.091), (I-655)+(1.020)+(1.092), (I-655)+(1.020)+(2.001), (I-655)+(1.020)+(2.002), (I-655)+(1.020)+(2.003), (I-655)+(1.020)+(2.004), (I-655)+(1.020)+(2.005), (I-655)+(1.020)+(2.006), (I-655)+(1.020)+(2.007), (I-655)+(1.020)+(2.008), (I-655)+(1.020)+(2.009), (I-655)+(1.020)+(2.010), (I-655)+(1.020)+(2.011), (I-655)+(1.020)+(2.012), (I-655)+(1.020)+(2.013), (I-655)+(1.020)+(2.014), (I-655)+(1.020)+(2.015), (I-655)+(1.020)+(2.016), (I-655)+(1.020)+(2.017), (I-655)+(1.020)+(2.018), (I-655)+(1.020)+(2.019), (I-655)+(1.020)+(2.020), (I-655)+(1.020)+(2.021), (I-655)+(1.020)+(2.022), (I-655)+(1.020)+(2.023), (I-655)+(1.020)+(2.024), (I-655)+(1.020)+(2.025), (I-655)+(1.020)+(2.026), (I-655)+(1.020)+(2.027), (I-655)+(1.020)+(2.028), (I-655)+(1.020)+(2.029), (I-655)+(1.020)+(2.030), (I-655)+(1.020)+(2.031), (I-655)+(1.020)+(2.032), (I-655)+(1.020)+(2.033), (I-655)+(1.020)+(2.034), (I-655)+(1.020)+(2.035), (I-655)+(1.020)+(2.036), (I-655)+(1.020)+(2.037), (I-655)+(1.020)+(2.038), (I-655)+(1.020)+(2.039), (I-655)+(1.020)+(2.040), (I-655)+(1.020)+(2.041), (I-655)+(1.020)+(2.042), (I-655)+(1.020)+(2.043), (I-655)+(1.020)+(2.044), (I-655)+(1.020)+(2.045), (I-655)+(1.020)+(2.046), (I-655)+(1.020)+(2.047), (I-655)+(1.020)+(2.048), (I-655)+(1.020)+(2.049), (I-655)+(1.020)+(2.050), (I-655)+(1.020)+(2.051), (I-655)+(1.020)+(2.052), (I-655)+(1.020)+(2.053), (I-655)+(1.020)+(2.054), (I-655)+(1.020)+(2.055), (I-655)+(1.020)+(2.056), (I-655)+(1.020)+(2.057), (I-655)+(1.020)+(2.058), (I-655)+(1.020)+(2.059), (I-655)+(1.020)+(3.001), (I-655)+(1.020)+(3.002), (I-655)+(1.020)+(3.003), (I-655)+(1.020)+(3.004), (I-655)+(1.020)+(3.005), (I-655)+(1.020)+(3.006), (I-655)+(1.020)+(3.007), (I-655)+(1.020)+(3.008), (I-655)+(1.020)+(3.009), (I-655)+(1.020)+(3.010), (I-655)+(1.020)+(3.011), (I-655)+(1.020)+(3.012), (I-655)+(1.020)+(3.013), (I-655)+(1.020)+(3.014), (I-655)+(1.020)+(3.015), (I-655)+(1.020)+(3.016), (I-655)+(1.020)+(3.017), (I-655)+(1.020)+(3.018), (I-655)+(1.020)+(3.019), (I-655)+(1.020)+(3.020), (I-655)+(1.020)+(3.021), (I-655)+(1.020)+(3.022), (I-655)+(1.020)+(3.023), (I-655)+(1.020)+(3.024), (I-655)+(1.020)+(3.025), (I-655)+(1.020)+(3.026), (I-655)+(1.020)+(3.027), (I-655)+(1.020)+(3.028), (I-655)+(1.020)+(3.029), (I-655)+(1.020)+(3.030), (I-655)+(1.020)+(3.031), (I-655)+(1.020)+(5.001), (I-655)+(1.020)+(5.002), (I-655)+(1.020)+(5.003), (I-655)+(1.020)+(5.004), (I-655)+(1.020)+(5.005), (I-655)+(1.020)+(5.006), (I-655)+(1.020)+(5.007), (I-655)+(1.020)+(5.008), (I-655)+(1.020)+(5.009), (I-655)+(1.020)+(5.010), (I-655)+(1.020)+(5.011), (I-655)+(1.020)+(5.012), (I-655)+(1.020)+(5.013), (I-655)+(1.020)+(5.014), (I-655)+(1.020)+(5.015), (I-655)+(1.020)+(5.016), (I-655)+(1.020)+(5.017), (I-655)+(1.020)+(5.018), (I-655)+(1.020)+(5.019), (I-655)+(1.020)+(5.020), (I-655)+(1.020)+(5.021), (I-655)+(1.020)+(5.022), (I-655)+(1.020)+(5.023), (I-655)+(1.020)+(6.001), (I-655)+(1.020)+(6.002), (I-655)+(1.020)+(6.003), (I-655)+(1.020)+(6.004), (I-655)+(1.020)+(7.001), (I-655)+(1.020)+(7.002), (I-655)+(1.020)+(7.003), (I-655)+(1.020)+(7.004), (I-655)+(1.020)+(7.005), (I-655)+(1.020)+(7.006), (I-655)+(1.020)+(9.001), (I-655)+(1.020)+(9.002), (I-655)+(1.020)+(9.003), (I-655)+(1.020)+(9.004), (I-655)+(1.020)+(9.005), (I-655)+(1.020)+(9.006), (I-655)+(1.020)+(9.007), (I-655)+(1.020)+(9.008), (I-655)+(1.020)+(9.009), (I-655)+(1.020)+(14.001), (I-655)+(1.020)+(14.002), (I-655)+(1.020)+(15.008), (I-655)+(1.020)+(15.011), (I-655)+(1.020)+(15.012), (I-655)+(1.020)+(15.016), (I-655)+(1.020)+(15.025), (I-655)+(1.020)+(15.027), (I-655)+(1.020)+(15.047), (I-655)+(1.020)+(15.063), (I-655)+(1.020)+(15.064), (I-655)+(1.020)+(16.001), (I-655)+(1.020)+(16.002), (I-655)+(1.020)+(16.003), (I-655)+(1.020)+(16.004), (I-655)+(1.020)+(16.005), (I-655)+(1.020)+(16.006), (I-655)+(1.020)+(16.007), (I-655)+(1.020)+(16.008), (I-655)+(1.020)+(17.001), (I-655)+(1.020)+(17.002), (I-655)+(1.020)+(17.003), (I-655)+(1.020)+(17.004), (I-655)+(1.020)+(17.005), (I-655)+(1.020)+(17.006), (I-655)+(1.020)+(17.007), (I-655)+(1.020)+(17.008), (I-655)+(1.020)+(17.009), (I-655)+(1.020)+(17.010), (I-655)+(1.020)+(17.011), (I-655)+(1.020)+(17.012), (I-655)+(1.020)+(18.001),

(I-655)+(1.021)+(1.022), (I-655)+(1.021)+(1.023), (I-655)+(1.021)+(1.024), (I-655)+(1.021)+(1.025), (I-655)+(1.021)+(1.026), (I-655)+(1.021)+(1.027), (I-655)+(1.021)+(1.028), (I-655)+(1.021)+(1.029), (I-655)+(1.021)+(1.030), (I-655)+(1.021)+(1.031), (I-655)+(1.021)+(1.032), (I-655)+(1.021)+(1.033), (I-655)+(1.021)+(1.034), (I-655)+(1.021)+(1.035), (I-655)+(1.021)+(1.036), (I-655)+(1.021)+(1.037), (I-655)+(1.021)+(1.038), (I-655)+(1.021)+(1.039), (I-655)+(1.021)+(1.040), (I-655)+(1.021)+(1.041), (I-655)+(1.021)+(1.042), (I-655)+(1.021)+(1.043), (I-655)+(1.021)+(1.044), (I-655)+(1.021)+(1.045), (I-655)+(1.021)+(1.046), (I-655)+(1.021)+(1.047), (I-655)+(1.021)+(1.048), (I-655)+(1.021)+(1.049), (I-655)+(1.021)+(1.050), (I-655)+(1.021)+(1.051), (I-655)+(1.021)+(1.052), (I-655)+(1.021)+(1.053), (I-655)+(1.021)+(1.054), (I-655)+(1.021)+(1.055), (I-655)+(1.021)+(1.056), (I-655)+(1.021)+(1.057), (I-655)+(1.021)+(1.058), (I-655)+(1.021)+(1.059), (I-655)+(1.021)+(1.060), (I-655)+(1.021)+(1.061), (I-655)+(1.021)+(1.062), (I-655)+(1.021)+(1.063), (I-655)+(1.021)+(1.064), (I-655)+(1.021)+(1.065), (I-655)+(1.021)+(1.066), (I-655)+(1.021)+(1.067), (I-655)+(1.021)+(1.068), (I-655)+(1.021)+(1.069), (I-655)+(1.021)+(1.070), (I-655)+(1.021)+(1.071), (I-655)+(1.021)+(1.072), (I-655)+(1.021)+(1.073), (I-655)+(1.021)+(1.074), (I-655)+(1.021)+(1.075), (I-655)+(1.021)+(1.076), (I-655)+(1.021)+(1.077), (I-655)+(1.021)+(1.078), (I-655)+(1.021)+(1.079), (I-655)+(1.021)+(1.080), (I-655)+(1.021)+(1.081), (I-655)+(1.021)+(1.082), (I-655)+(1.021)+(1.083), (I-655)+(1.021)+(1.084), (I-655)+(1.021)+(1.085), (I-655)+(1.021)+(1.086), (I-655)+(1.021)+(1.087), (I-655)+(1.021)+(1.088), (I-655)+(1.021)+(1.089), (I-655)+(1.021)+(1.090), (I-655)+(1.021)+(1.091), (I-655)+(1.021)+(1.092), (I-655)+(1.021)+(2.001), (I-655)+(1.021)+(2.002), (I-655)+(1.021)+(2.003), (I-655)+(1.021)+(2.004), (I-655)+(1.021)+(2.005), (I-655)+(1.021)+(2.006), (I-655)+(1.021)+(2.007), (I-655)+(1.021)+(2.008), (I-655)+(1.021)+(2.009), (I-655)+(1.021)+(2.010), (I-655)+(1.021)+(2.011), (I-655)+(1.021)+(2.012), (I-655)+(1.021)+(2.013), (I-655)+(1.021)+(2.014), (I-655)+(1.021)+(2.015), (I-655)+(1.021)+(2.016), (I-655)+(1.021)+(2.017), (I-655)+(1.021)+(2.018), (I-655)+(1.021)+(2.019), (I-655)+(1.021)+(2.020), (I-655)+(1.021)+(2.021), (I-655)+(1.021)+(2.022), (I-655)+(1.021)+(2.023), (I-655)+(1.021)+(2.024), (I-655)+(1.021)+(2.025), (I-655)+(1.021)+(2.026), (I-655)+(1.021)+(2.027), (I-655)+(1.021)+(2.028), (I-655)+(1.021)+(2.029), (I-655)+(1.021)+(2.030), (I-655)+(1.021)+(2.031), (I-655)+(1.021)+(2.032), (I-655)+(1.021)+(2.033), (I-655)+(1.021)+(2.034), (I-655)+(1.021)+(2.035), (I-655)+(1.021)+(2.036), (I-655)+(1.021)+(2.037), (I-655)+(1.021)+(2.038), (I-655)+(1.021)+(2.039), (I-655)+(1.021)+(2.040), (I-655)+(1.021)+(2.041), (I-655)+(1.021)+(2.042), (I-655)+(1.021)+(2.043), (I-655)+(1.021)+(2.044), (I-655)+(1.021)+(2.045), (I-655)+(1.021)+(2.046), (I-655)+(1.021)+(2.047), (I-655)+(1.021)+(2.048), (I-655)+(1.021)+(2.049), (I-655)+(1.021)+(2.050), (I-655)+(1.021)+(2.051), (I-655)+(1.021)+(2.052), (I-655)+(1.021)+(2.053), (I-655)+(1.021)+(2.054), (I-655)+(1.021)+(2.055), (I-655)+(1.021)+(2.056), (I-655)+(1.021)+(2.057), (I-655)+(1.021)+(2.058), (I-655)+(1.021)+(2.059), (I-655)+(1.021)+(3.001), (I-655)+(1.021)+(3.002), (I-655)+(1.021)+(3.003), (I-655)+(1.021)+(3.004), (I-655)+(1.021)+(3.005), (I-655)+(1.021)+(3.006), (I-655)+(1.021)+(3.007), (I-655)+(1.021)+(3.008), (I-655)+(1.021)+(3.009), (I-655)+(1.021)+(3.010), (I-655)+(1.021)+(3.011), (I-655)+(1.021)+(3.012), (I-655)+(1.021)+(3.013), (I-655)+(1.021)+(3.014), (I-655)+(1.021)+(3.015), (I-655)+(1.021)+(3.016), (I-655)+(1.021)+(3.017), (I-655)+(1.021)+(3.018), (I-655)+(1.021)+(3.019), (I-655)+(1.021)+(3.020), (I-655)+(1.021)+(3.021), (I-655)+(1.021)+(3.022), (I-655)+(1.021)+(3.023), (I-655)+(1.021)+(3.024), (I-655)+(1.021)+(3.025), (I-655)+(1.021)+(3.026), (I-655)+(1.021)+(3.027), (I-655)+(1.021)+(3.028), (I-655)+(1.021)+(3.029), (I-655)+(1.021)+(3.030), (I-655)+(1.021)+(3.031), (I-655)+(1.021)+(5.001), (I-655)+(1.021)+(5.002), (I-655)+(1.021)+(5.003), (I-655)+(1.021)+(5.004), (I-655)+(1.021)+(5.005), (I-655)+(1.021)+(5.006), (I-655)+(1.021)+(5.007), (I-655)+(1.021)+(5.008), (I-655)+(1.021)+(5.009), (I-655)+(1.021)+(5.010), (I-655)+(1.021)+(5.011), (I-655)+(1.021)+(5.012), (I-655)+(1.021)+(5.013), (I-655)+(1.021)+(5.014), (I-655)+(1.021)+(5.015), (I-655)+(1.021)+(5.016), (I-655)+(1.021)+(5.017), (I-655)+(1.021)+(5.018), (I-655)+(1.021)+(5.019), (I-655)+(1.021)+(5.020), (I-655)+(1.021)+(5.021), (I-655)+(1.021)+(5.022), (I-655)+(1.021)+(5.023), (I-655)+(1.021)+(6.001), (I-655)+(1.021)+(6.002), (I-655)+(1.021)+(6.003), (I-655)+(1.021)+(6.004), (I-655)+(1.021)+(7.001), (I-655)+(1.021)+(7.002), (I-655)+(1.021)+(7.003), (I-655)+(1.021)+(7.004), (I-655)+(1.021)+(7.005), (I-655)+(1.021)+(7.006), (I-655)+(1.021)+(9.001), (I-655)+(1.021)+(9.002), (I-655)+(1.021)+(9.003), (I-655)+(1.021)+(9.004), (I-655)+(1.021)+(9.005), (I-655)+(1.021)+(9.006), (I-655)+(1.021)+(9.007), (I-655)+(1.021)+(9.008), (I-655)+(1.021)+(9.009), (I-655)+(1.021)+(14.001), (I-655)+(1.021)+(14.002), (I-655)+(1.021)+(15.008), (I-655)+(1.021)+(15.011), (I-655)+(1.021)+(15.012), (I-655)+(1.021)+(15.016), (I-655)+(1.021)+(15.025), (I-655)+(1.021)+(15.027), (I-655)+(1.021)+(15.047), (I-655)+(1.021)+(15.063), (I-655)+(1.021)+(15.064), (I-655)+(1.021)+(16.001), (I-655)+(1.021)+(16.002), (I-655)+(1.021)+(16.003), (I-655)+(1.021)+(16.004), (I-655)+(1.021)+(16.005), (I-655)+(1.021)+(16.006), (I-655)+(1.021)+(16.007), (I-655)+(1.021)+(16.008), (I-655)+(1.021)+(17.001), (I-655)+(1.021)+(17.002), (I-655)+(1.021)+(17.003), (I-655)+(1.021)+(17.004), (I-655)+(1.021)+(17.005), (I-655)+(1.021)+(17.006), (I-655)+(1.021)+(17.007), (I-655)+(1.021)+(17.008), (I-655)+(1.021)+(17.009), (I-655)+(1.021)+(17.010), (I-655)+(1.021)+(17.011), (I-655)+(1.021)+(17.012), (I-655)+(1.021)+(18.001),

(I-655)+(1.022)+(1.023), (I-655)+(1.022)+(1.024), (I-655)+(1.022)+(1.025), (I-655)+(1.022)+(1.026), (I-655)+(1.022)+(1.027), (I-655)+(1.022)+(1.028), (I-655)+(1.022)+(1.029), (I-655)+(1.022)+(1.030), (I-655)+(1.022)+(1.031), (I-655)+(1.022)+(1.032), (I-655)+(1.022)+(1.033), (I-655)+(1.022)+(1.034), (I-655)+(1.022)+(1.035), (I-655)+(1.022)+(1.036), (I-655)+(1.022)+(1.037), (I-655)+(1.022)+(1.038), (I-655)+(1.022)+(1.039), (I-655)+(1.022)+(1.040), (I-655)+(1.022)+(1.041), (I-655)+(1.022)+(1.042), (I-655)+(1.022)+(1.043), (I-655)+(1.022)+(1.044), (I-655)+(1.022)+(1.045), (I-655)+(1.022)+(1.046), (I-655)+(1.022)+(1.047), (I-655)+(1.022)+(1.048), (I-655)+(1.022)+(1.049), (I-655)+(1.022)+(1.050), (I-655)+(1.022)+(1.051), (I-655)+(1.022)+(1.052), (I-655)+(1.022)+(1.053), (I-655)+(1.022)+(1.054), (I-655)+(1.022)+(1.055), (I-655)+(1.022)+(1.056), (I-655)+(1.022)+(1.057), (I-655)+(1.022)+(1.058), (I-655)+(1.022)+(1.059), (I-655)+(1.022)+(1.060), (I-655)+(1.022)+(1.061), (I-655)+(1.022)+(1.062), (I-655)+(1.022)+(1.063), (I-655)+(1.022)+(1.064), (I-655)+(1.022)+(1.065), (I-655)+(1.022)+(1.066), (I-655)+(1.022)+(1.067), (I-655)+(1.022)+(1.068), (I-655)+(1.022)+(1.069), (I-655)+(1.022)+(1.070), (I-655)+(1.022)+(1.071), (I-655)+(1.022)+(1.072), (I-655)+(1.022)+(1.073), (I-655)+(1.022)+(1.074), (I-655)+(1.022)+(1.075), (I-655)+(1.022)+(1.076), (I-655)+(1.022)+(1.077), (I-655)+(1.022)+(1.078), (I-655)+(1.022)+(1.079), (I-655)+(1.022)+(1.080), (I-655)+(1.022)+(1.081), (I-655)+(1.022)+(1.082), (I-655)+(1.022)+(1.083), (I-655)+(1.022)+(1.084), (I-655)+(1.022)+(1.085), (I-655)+(1.022)+(1.086), (I-655)+(1.022)+(1.087), (I-655)+(1.022)+(1.088), (I-655)+(1.022)+(1.089), (I-655)+(1.022)+(1.090), (I-655)+(1.022)+(1.091), (I-655)+(1.022)+(1.092), (I-655)+(1.022)+(2.001), (I-655)+(1.022)+(2.002), (I-655)+(1.022)+(2.003), (I-655)+(1.022)+(2.004), (I-655)+(1.022)+(2.005), (I-655)+(1.022)+(2.006), (I-655)+(1.022)+(2.007), (I-655)+(1.022)+(2.008), (I-655)+(1.022)+(2.009), (I-655)+(1.022)+(2.010), (I-655)+(1.022)+(2.011), (I-655)+(1.022)+(2.012), (I-655)+(1.022)+(2.013), (I-655)+(1.022)+(2.014), (I-655)+(1.022)+(2.015), (I-655)+(1.022)+(2.016), (I-655)+(1.022)+(2.017), (I-655)+(1.022)+(2.018), (I-655)+(1.022)+(2.019), (I-655)+(1.022)+(2.020), (I-655)+(1.022)+(2.021), (I-655)+(1.022)+(2.022), (I-655)+(1.022)+(2.023), (I-655)+(1.022)+(2.024), (I-655)+(1.022)+(2.025), (I-655)+(1.022)+(2.026), (I-655)+(1.022)+(2.027), (I-655)+(1.022)+(2.028), (I-655)+(1.022)+(2.029), (I-655)+(1.022)+(2.030), (I-655)+(1.022)+(2.031), (I-655)+(1.022)+(2.032), (I-655)+(1.022)+(2.033), (I-655)+(1.022)+(2.034), (I-655)+(1.022)+(2.035), (I-655)+(1.022)+(2.036), (I-655)+(1.022)+(2.037), (I-655)+(1.022)+(2.038), (I-655)+(1.022)+(2.039), (I-655)+(1.022)+(2.040), (I-655)+(1.022)+(2.041), (I-655)+(1.022)+(2.042), (I-655)+(1.022)+(2.043), (I-655)+(1.022)+(2.044), (I-655)+(1.022)+(2.045), (I-655)+(1.022)+(2.046), (I-655)+(1.022)+(2.047), (I-655)+(1.022)+(2.048), (I-655)+(1.022)+(2.049), (I-655)+(1.022)+(2.050), (I-655)+(1.022)+(2.051), (I-655)+(1.022)+(2.052), (I-655)+(1.022)+(2.053), (I-655)+(1.022)+(2.054), (I-655)+(1.022)+(2.055), (I-655)+(1.022)+(2.056), (I-655)+(1.022)+(2.057), (I-655)+(1.022)+(2.058), (I-655)+(1.022)+(2.059), (I-655)+(1.022)+(3.001), (I-655)+(1.022)+(3.002), (I-655)+(1.022)+(3.003), (I-655)+(1.022)+(3.004), (I-655)+(1.022)+(3.005), (I-655)+(1.022)+(3.006), (I-655)+(1.022)+(3.007), (I-655)+(1.022)+(3.008), (I-655)+(1.022)+(3.009), (I-655)+(1.022)+(3.010), (I-655)+(1.022)+(3.011), (I-655)+(1.022)+(3.012), (I-655)+(1.022)+(3.013), (I-655)+(1.022)+(3.014), (I-655)+(1.022)+(3.015), (I-655)+(1.022)+(3.016), (I-655)+(1.022)+(3.017), (I-655)+(1.022)+(3.018), (I-655)+(1.022)+(3.019), (I-655)+(1.022)+(3.020), (I-655)+(1.022)+(3.021), (I-655)+(1.022)+(3.022), (I-655)+(1.022)+(3.023), (I-655)+(1.022)+(3.024), (I-655)+(1.022)+(3.025), (I-655)+(1.022)+(3.026), (I-655)+(1.022)+(3.027), (I-655)+(1.022)+(3.028), (I-655)+(1.022)+(3.029), (I-655)+(1.022)+(3.030), (I-655)+(1.022)+(3.031), (I-655)+(1.022)+(5.001), (I-655)+(1.022)+(5.002), (I-655)+(1.022)+(5.003), (I-655)+(1.022)+(5.004), (I-655)+(1.022)+(5.005), (I-655)+(1.022)+(5.006), (I-655)+(1.022)+(5.007), (I-655)+(1.022)+(5.008), (I-655)+(1.022)+(5.009), (I-655)+(1.022)+(5.010), (I-655)+(1.022)+(5.011), (I-655)+(1.022)+(5.012), (I-655)+(1.022)+(5.013), (I-655)+(1.022)+(5.014), (I-655)+(1.022)+(5.015), (I-655)+(1.022)+(5.016), (I-655)+(1.022)+(5.017), (I-655)+(1.022)+(5.018), (I-655)+(1.022)+(5.019), (I-655)+(1.022)+(5.020), (I-655)+(1.022)+(5.021), (I-655)+(1.022)+(5.022), (I-655)+(1.022)+(5.023), (I-655)+(1.022)+(6.001), (I-655)+(1.022)+(6.002), (I-655)+(1.022)+(6.003), (I-655)+(1.022)+(6.004), (I-655)+(1.022)+(7.001), (I-655)+(1.022)+(7.002), (I-655)+(1.022)+(7.003), (I-655)+(1.022)+(7.004), (I-655)+(1.022)+(7.005), (I-655)+(1.022)+(7.006), (I-655)+(1.022)+(9.001), (I-655)+(1.022)+(9.002), (I-655)+(1.022)+(9.003), (I-655)+(1.022)+(9.004), (I-655)+(1.022)+(9.005), (I-655)+(1.022)+(9.006), (I-655)+(1.022)+(9.007), (I-655)+(1.022)+(9.008), (I-655)+(1.022)+(9.009), (I-655)+(1.022)+(14.001), (I-655)+(1.022)+(14.002), (I-655)+(1.022)+(15.008), (I-655)+(1.022)+(15.011), (I-655)+(1.022)+(15.012), (I-655)+(1.022)+(15.016), (I-655)+(1.022)+(15.025), (I-655)+(1.022)+(15.027), (I-655)+(1.022)+(15.047), (I-655)+(1.022)+(15.063), (I-655)+(1.022)+(15.064), (I-655)+(1.022)+(16.001), (I-655)+(1.022)+(16.002), (I-655)+(1.022)+(16.003), (I-655)+(1.022)+(16.004), (I-655)+(1.022)+(16.005), (I-655)+(1.022)+(16.006), (I-655)+(1.022)+(16.007), (I-655)+(1.022)+(16.008), (I-655)+(1.022)+(17.001), (I-655)+(1.022)+(17.002), (I-655)+(1.022)+(17.003), (I-655)+(1.022)+(17.004), (I-655)+(1.022)+(17.005), (I-655)+(1.022)+(17.006), (I-655)+(1.022)+(17.007), (I-655)+(1.022)+(17.008), (I-655)+(1.022)+(17.009), (I-655)+(1.022)+(17.010), (I-655)+(1.022)+(17.011), (I-655)+(1.022)+(17.012), (I-655)+(1.022)+(18.001),

(I-655)+(1.023)+(1.024), (I-655)+(1.023)+(1.025), (I-655)+(1.023)+(1.026), (I-655)+(1.023)+(1.027), (I-655)+(1.023)+(1.028), (I-655)+(1.023)+(1.029), (I-655)+(1.023)+(1.030), (I-655)+(1.023)+(1.031), (I-655)+(1.023)+(1.032), (I-655)+(1.023)+(1.033), (I-655)+(1.023)+(1.034), (I-655)+(1.023)+(1.035), (I-655)+(1.023)+(1.036), (I-655)+(1.023)+(1.037), (I-655)+(1.023)+(1.038), (I-655)+(1.023)+(1.039), (I-655)+(1.023)+(1.040), (I-655)+(1.023)+(1.041), (I-655)+(1.023)+(1.042), (I-655)+(1.023)+(1.043), (I-655)+(1.023)+(1.044), (I-655)+(1.023)+(1.045), (I-655)+(1.023)+(1.046), (I-655)+(1.023)+(1.047), (I-655)+(1.023)+(1.048), (I-655)+(1.023)+(1.049), (I-655)+(1.023)+(1.050), (I-655)+(1.023)+(1.051), (I-655)+(1.023)+(1.052), (I-655)+(1.023)+(1.053), (I-655)+(1.023)+(1.054), (I-655)+(1.023)+(1.055), (I-655)+(1.023)+(1.056), (I-655)+(1.023)+(1.057), (I-655)+(1.023)+(1.058), (I-655)+(1.023)+(1.059), (I-655)+(1.023)+(1.060), (I-655)+(1.023)+(1.061), (I-655)+(1.023)+(1.062), (I-655)+(1.023)+(1.063), (I-655)+(1.023)+(1.064), (I-655)+(1.023)+(1.065), (I-655)+(1.023)+(1.066), (I-655)+(1.023)+(1.067), (I-655)+(1.023)+(1.068), (I-655)+(1.023)+(1.069), (I-655)+(1.023)+(1.070), (I-655)+(1.023)+(1.071), (I-655)+(1.023)+(1.072), (I-655)+(1.023)+(1.073), (I-655)+(1.023)+(1.074), (I-655)+(1.023)+(1.075), (I-655)+(1.023)+(1.076), (I-655)+(1.023)+(1.077), (I-655)+(1.023)+(1.078), (I-655)+(1.023)+(1.079), (I-655)+(1.023)+(1.080), (I-655)+(1.023)+(1.081), (I-655)+(1.023)+(1.082), (I-655)+(1.023)+(1.083), (I-655)+(1.023)+(1.084), (I-655)+(1.023)+(1.085), (I-655)+(1.023)+(1.086), (I-655)+(1.023)+(1.087), (I-655)+(1.023)+(1.088), (I-655)+(1.023)+(1.089), (I-655)+(1.023)+(1.090), (I-655)+(1.023)+(1.091), (I-655)+(1.023)+(1.092), (I-655)+(1.023)+(2.001), (I-655)+(1.023)+(2.002), (I-655)+(1.023)+(2.003), (I-655)+(1.023)+(2.004), (I-655)+(1.023)+(2.005), (I-655)+(1.023)+(2.006), (I-655)+(1.023)+(2.007), (I-655)+(1.023)+(2.008), (I-655)+(1.023)+(2.009), (I-655)+(1.023)+(2.010), (I-655)+(1.023)+(2.011), (I-655)+(1.023)+(2.012), (I-655)+(1.023)+(2.013), (I-655)+(1.023)+(2.014), (I-655)+(1.023)+(2.015), (I-655)+(1.023)+(2.016), (I-655)+(1.023)+(2.017), (I-655)+(1.023)+(2.018), (I-655)+(1.023)+(2.019), (I-655)+(1.023)+(2.020), (I-655)+(1.023)+(2.021), (I-655)+(1.023)+(2.022), (I-655)+(1.023)+(2.023), (I-655)+(1.023)+(2.024), (I-655)+(1.023)+(2.025), (I-655)+(1.023)+(2.026), (I-655)+(1.023)+(2.027), (I-655)+(1.023)+(2.028), (I-655)+(1.023)+(2.029), (I-655)+(1.023)+(2.030), (I-655)+(1.023)+(2.031), (I-655)+(1.023)+(2.032), (I-655)+(1.023)+(2.033), (I-655)+(1.023)+(2.034), (I-655)+(1.023)+(2.035), (I-655)+(1.023)+(2.036), (I-655)+(1.023)+(2.037), (I-655)+(1.023)+(2.038), (I-655)+(1.023)+(2.039), (I-655)+(1.023)+(2.040), (I-655)+(1.023)+(2.041), (I-655)+(1.023)+(2.042), (I-655)+(1.023)+(2.043), (I-655)+(1.023)+(2.044), (I-655)+(1.023)+(2.045), (I-655)+(1.023)+(2.046), (I-655)+(1.023)+(2.047), (I-655)+(1.023)+(2.048), (I-655)+(1.023)+(2.049), (I-655)+(1.023)+(2.050), (I-655)+(1.023)+(2.051), (I-655)+(1.023)+(2.052), (I-655)+(1.023)+(2.053), (I-655)+(1.023)+(2.054), (I-655)+(1.023)+(2.055), (I-655)+(1.023)+(2.056), (I-655)+(1.023)+(2.057), (I-655)+(1.023)+(2.058), (I-655)+(1.023)+(2.059), (I-655)+(1.023)+(3.001), (I-655)+(1.023)+(3.002), (I-655)+(1.023)+(3.003), (I-655)+(1.023)+(3.004), (I-655)+(1.023)+(3.005), (I-655)+(1.023)+(3.006), (I-655)+(1.023)+(3.007), (I-655)+(1.023)+(3.008), (I-655)+(1.023)+(3.009), (I-655)+(1.023)+(3.010), (I-655)+(1.023)+(3.011), (I-655)+(1.023)+(3.012), (I-655)+(1.023)+(3.013), (I-655)+(1.023)+(3.014), (I-655)+(1.023)+(3.015), (I-655)+(1.023)+(3.016), (I-655)+(1.023)+(3.017), (I-655)+(1.023)+(3.018), (I-655)+(1.023)+(3.019), (I-655)+(1.023)+(3.020), (I-655)+(1.023)+(3.021), (I-655)+(1.023)+(3.022), (I-655)+(1.023)+(3.023), (I-655)+(1.023)+(3.024), (I-655)+(1.023)+(3.025), (I-655)+(1.023)+(3.026), (I-655)+(1.023)+(3.027), (I-655)+(1.023)+(3.028), (I-655)+(1.023)+(3.029), (I-655)+(1.023)+(3.030), (I-655)+(1.023)+(3.031), (I-655)+(1.023)+(5.001), (I-655)+(1.023)+(5.002), (I-655)+(1.023)+(5.003), (I-655)+(1.023)+(5.004), (I-655)+(1.023)+(5.005), (I-655)+(1.023)+(5.006), (I-655)+(1.023)+(5.007), (I-655)+(1.023)+(5.008), (I-655)+(1.023)+(5.009), (I-655)+(1.023)+(5.010), (I-655)+(1.023)+(5.011), (I-655)+(1.023)+(5.012), (I-655)+(1.023)+(5.013), (I-655)+(1.023)+(5.014), (I-655)+(1.023)+(5.015), (I-655)+(1.023)+(5.016), (I-655)+(1.023)+(5.017), (I-655)+(1.023)+(5.018), (I-655)+(1.023)+(5.019), (I-655)+(1.023)+(5.020), (I-655)+(1.023)+(5.021), (I-655)+(1.023)+(5.022), (I-655)+(1.023)+(5.023), (I-655)+(1.023)+(6.001), (I-655)+(1.023)+(6.002), (I-655)+(1.023)+(6.003), (I-655)+(1.023)+(6.004), (I-655)+(1.023)+(7.001), (I-655)+(1.023)+(7.002), (I-655)+(1.023)+(7.003), (I-655)+(1.023)+(7.004), (I-655)+(1.023)+(7.005), (I-655)+(1.023)+(7.006), (I-655)+(1.023)+(9.001), (I-655)+(1.023)+(9.002), (I-655)+(1.023)+(9.003), (I-655)+(1.023)+(9.004), (I-655)+(1.023)+(9.005), (I-655)+(1.023)+(9.006), (I-655)+(1.023)+(9.007), (I-655)+(1.023)+(9.008), (I-655)+(1.023)+(9.009), (I-655)+(1.023)+(14.001), (I-655)+(1.023)+(14.002), (I-655)+(1.023)+(15.008), (I-655)+(1.023)+(15.011), (I-655)+(1.023)+(15.012), (I-655)+(1.023)+(15.016), (I-655)+(1.023)+(15.025), (I-655)+(1.023)+(15.027), (I-655)+(1.023)+(15.047), (I-655)+(1.023)+(15.063), (I-655)+(1.023)+(15.064), (I-655)+(1.023)+(16.001), (I-655)+(1.023)+(16.002), (I-655)+(1.023)+(16.003), (I-655)+(1.023)+(16.004), (I-655)+(1.023)+(16.005), (I-655)+(1.023)+(16.006), (I-655)+(1.023)+(16.007), (I-655)+(1.023)+(16.008), (I-655)+(1.023)+(17.001), (I-655)+(1.023)+(17.002), (I-655)+(1.023)+(17.003), (I-655)+(1.023)+(17.004), (I-655)+(1.023)+(17.005), (I-655)+(1.023)+(17.006), (I-655)+(1.023)+(17.007), (I-655)+(1.023)+(17.008), (I-655)+(1.023)+(17.009), (I-655)+(1.023)+(17.010), (I-655)+(1.023)+(17.011), (I-655)+(1.023)+(17.012), (I-655)+(1.023)+(18.001),

(I-655)+(1.024)+(1.025), (I-655)+(1.024)+(1.026), (I-655)+(1.024)+(1.027), (I-655)+(1.024)+(1.028), (I-655)+(1.024)+(1.029), (I-655)+(1.024)+(1.030), (I-655)+(1.024)+(1.031), (I-655)+(1.024)+(1.032), (I-655)+(1.024)+(1.033), (I-655)+(1.024)+(1.034), (I-655)+(1.024)+(1.035), (I-655)+(1.024)+(1.036), (I-655)+(1.024)+(1.037), (I-655)+(1.024)+(1.038), (I-655)+(1.024)+(1.039), (I-655)+(1.024)+(1.040), (I-655)+(1.024)+(1.041), (I-655)+(1.024)+(1.042), (I-655)+(1.024)+(1.043), (I-655)+(1.024)+(1.044), (I-655)+(1.024)+(1.045), (I-655)+(1.024)+(1.046), (I-655)+(1.024)+(1.047), (I-655)+(1.024)+(1.048), (I-655)+(1.024)+(1.049), (I-655)+(1.024)+(1.050), (I-655)+(1.024)+(1.051), (I-655)+(1.024)+(1.052), (I-655)+(1.024)+(1.053), (I-655)+(1.024)+(1.054), (I-655)+(1.024)+(1.055), (I-655)+(1.024)+(1.056), (I-655)+(1.024)+(1.057), (I-655)+(1.024)+(1.058), (I-655)+(1.024)+(1.059), (I-655)+(1.024)+(1.060), (I-655)+(1.024)+(1.061), (I-655)+(1.024)+(1.062), (I-655)+(1.024)+(1.063), (I-655)+(1.024)+(1.064), (I-655)+(1.024)+(1.065), (I-655)+(1.024)+(1.066), (I-655)+(1.024)+(1.067), (I-655)+(1.024)+(1.068), (I-655)+(1.024)+(1.069), (I-655)+(1.024)+(1.070), (I-655)+(1.024)+(1.071), (I-655)+(1.024)+(1.072), (I-655)+(1.024)+(1.073), (I-655)+(1.024)+(1.074), (I-655)+(1.024)+(1.075), (I-655)+(1.024)+(1.076), (I-655)+(1.024)+(1.077), (I-655)+(1.024)+(1.078), (I-655)+(1.024)+(1.079), (I-655)+(1.024)+(1.080), (I-655)+(1.024)+(1.081), (I-655)+(1.024)+(1.082), (I-655)+(1.024)+(1.083), (I-655)+(1.024)+(1.084), (I-655)+(1.024)+(1.085), (I-655)+(1.024)+(1.086), (I-655)+(1.024)+(1.087), (I-655)+(1.024)+(1.088), (I-655)+(1.024)+(1.089), (I-655)+(1.024)+(1.090), (I-655)+(1.024)+(1.091), (I-655)+(1.024)+(1.092), (I-655)+(1.024)+(2.001), (I-655)+(1.024)+(2.002), (I-655)+(1.024)+(2.003), (I-655)+(1.024)+(2.004), (I-655)+(1.024)+(2.005), (I-655)+(1.024)+(2.006), (I-655)+(1.024)+(2.007), (I-655)+(1.024)+(2.008), (I-655)+(1.024)+(2.009), (I-655)+(1.024)+(2.010), (I-655)+(1.024)+(2.011), (I-655)+(1.024)+(2.012), (I-655)+(1.024)+(2.013), (I-655)+(1.024)+(2.014), (I-655)+(1.024)+(2.015), (I-655)+(1.024)+(2.016), (I-655)+(1.024)+(2.017), (I-655)+(1.024)+(2.018), (I-655)+(1.024)+(2.019), (I-655)+(1.024)+(2.020), (I-655)+(1.024)+(2.021), (I-655)+(1.024)+(2.022), (I-655)+(1.024)+(2.023), (I-655)+(1.024)+(2.024), (I-655)+(1.024)+(2.025), (I-655)+(1.024)+(2.026), (I-655)+(1.024)+(2.027), (I-655)+(1.024)+(2.028), (I-655)+(1.024)+(2.029), (I-655)+(1.024)+(2.030), (I-655)+(1.024)+(2.031), (I-655)+(1.024)+(2.032), (I-655)+(1.024)+(2.033), (I-655)+(1.024)+(2.034), (I-655)+(1.024)+(2.035), (I-655)+(1.024)+(2.036), (I-655)+(1.024)+(2.037), (I-655)+(1.024)+(2.038), (I-655)+(1.024)+(2.039), (I-655)+(1.024)+(2.040), (I-655)+(1.024)+(2.041), (I-655)+(1.024)+(2.042), (I-655)+(1.024)+(2.043), (I-655)+(1.024)+(2.044), (I-655)+(1.024)+(2.045), (I-655)+(1.024)+(2.046), (I-655)+(1.024)+(2.047), (I-655)+(1.024)+(2.048), (I-655)+(1.024)+(2.049), (I-655)+(1.024)+(2.050), (I-655)+(1.024)+(2.051), (I-655)+(1.024)+(2.052), (I-655)+(1.024)+(2.053), (I-655)+(1.024)+(2.054), (I-655)+(1.024)+(2.055), (I-655)+(1.024)+(2.056), (I-655)+(1.024)+(2.057), (I-655)+(1.024)+(2.058), (I-655)+(1.024)+(2.059), (I-655)+(1.024)+(3.001), (I-655)+(1.024)+(3.002), (I-655)+(1.024)+(3.003), (I-655)+(1.024)+(3.004), (I-655)+(1.024)+(3.005), (I-655)+(1.024)+(3.006), (I-655)+(1.024)+(3.007), (I-655)+(1.024)+(3.008), (I-655)+(1.024)+(3.009), (I-655)+(1.024)+(3.010), (I-655)+(1.024)+(3.011), (I-655)+(1.024)+(3.012), (I-655)+(1.024)+(3.013), (I-655)+(1.024)+(3.014), (I-655)+(1.024)+(3.015), (I-655)+(1.024)+(3.016), (I-655)+(1.024)+(3.017), (I-655)+(1.024)+(3.018), (I-655)+(1.024)+(3.019), (I-655)+(1.024)+(3.020), (I-655)+(1.024)+(3.021), (I-655)+(1.024)+(3.022), (I-655)+(1.024)+(3.023), (I-655)+(1.024)+(3.024), (I-655)+(1.024)+(3.025), (I-655)+(1.024)+(3.026), (I-655)+(1.024)+(3.027), (I-655)+(1.024)+(3.028), (I-655)+(1.024)+(3.029), (I-655)+(1.024)+(3.030), (I-655)+(1.024)+(3.031), (I-655)+(1.024)+(5.001), (I-655)+(1.024)+(5.002), (I-655)+(1.024)+(5.003), (I-655)+(1.024)+(5.004), (I-655)+(1.024)+(5.005), (I-655)+(1.024)+(5.006), (I-655)+(1.024)+(5.007), (I-655)+(1.024)+(5.008), (I-655)+(1.024)+(5.009), (I-655)+(1.024)+(5.010), (I-655)+(1.024)+(5.011), (I-655)+(1.024)+(5.012), (I-655)+(1.024)+(5.013), (I-655)+(1.024)+(5.014), (I-655)+(1.024)+(5.015), (I-655)+(1.024)+(5.016), (I-655)+(1.024)+(5.017), (I-655)+(1.024)+(5.018), (I-655)+(1.024)+(5.019), (I-655)+(1.024)+(5.020), (I-655)+(1.024)+(5.021), (I-655)+(1.024)+(5.022), (I-655)+(1.024)+(5.023), (I-655)+(1.024)+(6.001), (I-655)+(1.024)+(6.002), (I-655)+(1.024)+(6.003), (I-655)+(1.024)+(6.004), (I-655)+(1.024)+(7.001), (I-655)+(1.024)+(7.002), (I-655)+(1.024)+(7.003), (I-655)+(1.024)+(7.004), (I-655)+(1.024)+(7.005), (I-655)+(1.024)+(7.006), (I-655)+(1.024)+(9.001), (I-655)+(1.024)+(9.002), (I-655)+(1.024)+(9.003), (I-655)+(1.024)+(9.004), (I-655)+(1.024)+(9.005), (I-655)+(1.024)+(9.006), (I-655)+(1.024)+(9.007), (I-655)+(1.024)+(9.008), (I-655)+(1.024)+(9.009), (I-655)+(1.024)+(14.001), (I-655)+(1.024)+(14.002), (I-655)+(1.024)+(15.008), (I-655)+(1.024)+(15.011), (I-655)+(1.024)+(15.012), (I-655)+(1.024)+(15.016), (I-655)+(1.024)+(15.025), (I-655)+(1.024)+(15.027), (I-655)+(1.024)+(15.047), (I-655)+(1.024)+(15.063), (I-655)+(1.024)+(15.064), (I-655)+(1.024)+(16.001), (I-655)+(1.024)+(16.002), (I-655)+(1.024)+(16.003), (I-655)+(1.024)+(16.004), (I-655)+(1.024)+(16.005), (I-655)+(1.024)+(16.006), (I-655)+(1.024)+(16.007), (I-655)+(1.024)+(16.008), (I-655)+(1.024)+(17.001), (I-655)+(1.024)+(17.002), (I-655)+(1.024)+(17.003), (I-655)+(1.024)+(17.004), (I-655)+(1.024)+(17.005), (I-655)+(1.024)+(17.006), (I-655)+(1.024)+(17.007), (I-655)+(1.024)+(17.008), (I-655)+(1.024)+(17.009), (I-655)+(1.024)+(17.010), (I-655)+(1.024)+(17.011), (I-655)+(1.024)+(17.012), (I-655)+(1.024)+(18.001),

(I-655)+(1.025)+(1.026), (I-655)+(1.025)+(1.027), (I-655)+(1.025)+(1.028), (I-655)+(1.025)+(1.029), (I-655)+(1.025)+(1.030), (I-655)+(1.025)+(1.031), (I-655)+(1.025)+(1.032), (I-655)+(1.025)+(1.033), (I-655)+(1.025)+(1.034), (I-655)+(1.025)+(1.035), (I-655)+(1.025)+(1.036), (I-655)+(1.025)+(1.037), (I-655)+(1.025)+(1.038), (I-655)+(1.025)+(1.039), (I-655)+(1.025)+(1.040), (I-655)+(1.025)+(1.041), (I-655)+(1.025)+(1.042), (I-655)+(1.025)+(1.043), (I-655)+(1.025)+(1.044), (I-655)+(1.025)+(1.045), (I-655)+(1.025)+(1.046), (I-655)+(1.025)+(1.047), (I-655)+(1.025)+(1.048), (I-655)+(1.025)+(1.049), (I-655)+(1.025)+(1.050), (I-655)+(1.025)+(1.051), (I-655)+(1.025)+(1.052), (I-655)+(1.025)+(1.053), (I-655)+(1.025)+(1.054), (I-655)+(1.025)+(1.055), (I-655)+(1.025)+(1.056), (I-655)+(1.025)+(1.057), (I-655)+(1.025)+(1.058), (I-655)+(1.025)+(1.059), (I-655)+(1.025)+(1.060), (I-655)+(1.025)+(1.061), (I-655)+(1.025)+(1.062), (I-655)+(1.025)+(1.063), (I-655)+(1.025)+(1.064), (I-655)+(1.025)+(1.065), (I-655)+(1.025)+(1.066), (I-655)+(1.025)+(1.067), (I-655)+(1.025)+(1.068), (I-655)+(1.025)+(1.069), (I-655)+(1.025)+(1.070), (I-655)+(1.025)+(1.071), (I-655)+(1.025)+(1.072), (I-655)+(1.025)+(1.073), (I-655)+(1.025)+(1.074), (I-655)+(1.025)+(1.075), (I-655)+(1.025)+(1.076), (I-655)+(1.025)+(1.077), (I-655)+(1.025)+(1.078), (I-655)+(1.025)+(1.079), (I-655)+(1.025)+(1.080), (I-655)+(1.025)+(1.081), (I-655)+(1.025)+(1.082), (I-655)+(1.025)+(1.083), (I-655)+(1.025)+(1.084), (I-655)+(1.025)+(1.085), (I-655)+(1.025)+(1.086), (I-655)+(1.025)+(1.087), (I-655)+(1.025)+(1.088), (I-655)+(1.025)+(1.089), (I-655)+(1.025)+(1.090), (I-655)+(1.025)+(1.091), (I-655)+(1.025)+(1.092), (I-655)+(1.025)+(2.001), (I-655)+(1.025)+(2.002), (I-655)+(1.025)+(2.003), (I-655)+(1.025)+(2.004), (I-655)+(1.025)+(2.005), (I-655)+(1.025)+(2.006), (I-655)+(1.025)+(2.007), (I-655)+(1.025)+(2.008), (I-655)+(1.025)+(2.009), (I-655)+(1.025)+(2.010), (I-655)+(1.025)+(2.011), (I-655)+(1.025)+(2.012), (I-655)+(1.025)+(2.013), (I-655)+(1.025)+(2.014), (I-655)+(1.025)+(2.015), (I-655)+(1.025)+(2.016), (I-655)+(1.025)+(2.017), (I-655)+(1.025)+(2.018), (I-655)+(1.025)+(2.019), (I-655)+(1.025)+(2.020), (I-655)+(1.025)+(2.021), (I-655)+(1.025)+(2.022), (I-655)+(1.025)+(2.023), (I-655)+(1.025)+(2.024), (I-655)+(1.025)+(2.025), (I-655)+(1.025)+(2.026), (I-655)+(1.025)+(2.027), (I-655)+(1.025)+(2.028), (I-655)+(1.025)+(2.029), (I-655)+(1.025)+(2.030), (I-655)+(1.025)+(2.031), (I-655)+(1.025)+(2.032), (I-655)+(1.025)+(2.033), (I-655)+(1.025)+(2.034), (I-655)+(1.025)+(2.035), (I-655)+(1.025)+(2.036), (I-655)+(1.025)+(2.037), (I-655)+(1.025)+(2.038), (I-655)+(1.025)+(2.039), (I-655)+(1.025)+(2.040), (I-655)+(1.025)+(2.041), (I-655)+(1.025)+(2.042), (I-655)+(1.025)+(2.043), (I-655)+(1.025)+(2.044), (I-655)+(1.025)+(2.045), (I-655)+(1.025)+(2.046), (I-655)+(1.025)+(2.047), (I-655)+(1.025)+(2.048), (I-655)+(1.025)+(2.049), (I-655)+(1.025)+(2.050), (I-655)+(1.025)+(2.051), (I-655)+(1.025)+(2.052), (I-655)+(1.025)+(2.053), (I-655)+(1.025)+(2.054), (I-655)+(1.025)+(2.055), (I-655)+(1.025)+(2.056), (I-655)+(1.025)+(2.057), (I-655)+(1.025)+(2.058), (I-655)+(1.025)+(2.059), (I-655)+(1.025)+(3.001), (I-655)+(1.025)+(3.002), (I-655)+(1.025)+(3.003), (I-655)+(1.025)+(3.004), (I-655)+(1.025)+(3.005), (I-655)+(1.025)+(3.006), (I-655)+(1.025)+(3.007), (I-655)+(1.025)+(3.008), (I-655)+(1.025)+(3.009), (I-655)+(1.025)+(3.010), (I-655)+(1.025)+(3.011), (I-655)+(1.025)+(3.012), (I-655)+(1.025)+(3.013), (I-655)+(1.025)+(3.014), (I-655)+(1.025)+(3.015), (I-655)+(1.025)+(3.016), (I-655)+(1.025)+(3.017), (I-655)+(1.025)+(3.018), (I-655)+(1.025)+(3.019), (I-655)+(1.025)+(3.020), (I-655)+(1.025)+(3.021), (I-655)+(1.025)+(3.022), (I-655)+(1.025)+(3.023), (I-655)+(1.025)+(3.024), (I-655)+(1.025)+(3.025), (I-655)+(1.025)+(3.026), (I-655)+(1.025)+(3.027), (I-655)+(1.025)+(3.028), (I-655)+(1.025)+(3.029), (I-655)+(1.025)+(3.030), (I-655)+(1.025)+(3.031), (I-655)+(1.025)+(5.001), (I-655)+(1.025)+(5.002), (I-655)+(1.025)+(5.003), (I-655)+(1.025)+(5.004), (I-655)+(1.025)+(5.005), (I-655)+(1.025)+(5.006), (I-655)+(1.025)+(5.007), (I-655)+(1.025)+(5.008), (I-655)+(1.025)+(5.009), (I-655)+(1.025)+(5.010), (I-655)+(1.025)+(5.011), (I-655)+(1.025)+(5.012), (I-655)+(1.025)+(5.013), (I-655)+(1.025)+(5.014), (I-655)+(1.025)+(5.015), (I-655)+(1.025)+(5.016), (I-655)+(1.025)+(5.017), (I-655)+(1.025)+(5.018), (I-655)+(1.025)+(5.019), (I-655)+(1.025)+(5.020), (I-655)+(1.025)+(5.021), (I-655)+(1.025)+(5.022), (I-655)+(1.025)+(5.023), (I-655)+(1.025)+(6.001), (I-655)+(1.025)+(6.002), (I-655)+(1.025)+(6.003), (I-655)+(1.025)+(6.004), (I-655)+(1.025)+(7.001), (I-655)+(1.025)+(7.002), (I-655)+(1.025)+(7.003), (I-655)+(1.025)+(7.004), (I-655)+(1.025)+(7.005), (I-655)+(1.025)+(7.006), (I-655)+(1.025)+(9.001), (I-655)+(1.025)+(9.002), (I-655)+(1.025)+(9.003), (I-655)+(1.025)+(9.004), (I-655)+(1.025)+(9.005), (I-655)+(1.025)+(9.006), (I-655)+(1.025)+(9.007), (I-655)+(1.025)+(9.008), (I-655)+(1.025)+(9.009), (I-655)+(1.025)+(14.001), (I-655)+(1.025)+(14.002), (I-655)+(1.025)+(15.008), (I-655)+(1.025)+(15.011), (I-655)+(1.025)+(15.012), (I-655)+(1.025)+(15.016), (I-655)+(1.025)+(15.025), (I-655)+(1.025)+(15.027), (I-655)+(1.025)+(15.047), (I-655)+(1.025)+(15.063), (I-655)+(1.025)+(15.064), (I-655)+(1.025)+(16.001), (I-655)+(1.025)+(16.002), (I-655)+(1.025)+(16.003), (I-655)+(1.025)+(16.004), (I-655)+(1.025)+(16.005), (I-655)+(1.025)+(16.006), (I-655)+(1.025)+(16.007), (I-655)+(1.025)+(16.008), (I-655)+(1.025)+(17.001), (I-655)+(1.025)+(17.002), (I-655)+(1.025)+(17.003), (I-655)+(1.025)+(17.004), (I-655)+(1.025)+(17.005), (I-655)+(1.025)+(17.006), (I-655)+(1.025)+(17.007), (I-655)+(1.025)+(17.008), (I-655)+(1.025)+(17.009), (I-655)+(1.025)+(17.010), (I-655)+(1.025)+(17.011), (I-655)+(1.025)+(17.012), (I-655)+(1.025)+(18.001),

(I-655)+(1.026)+(1.027), (I-655)+(1.026)+(1.028), (I-655)+(1.026)+(1.029), (I-655)+(1.026)+(1.030), (I-655)+(1.026)+(1.031), (I-655)+(1.026)+(1.032), (I-655)+(1.026)+(1.033), (I-655)+(1.026)+(1.034), (I-655)+(1.026)+(1.035), (I-655)+(1.026)+(1.036), (I-655)+(1.026)+(1.037), (I-655)+(1.026)+(1.038), (I-655)+(1.026)+(1.039), (I-655)+(1.026)+(1.040), (I-655)+(1.026)+(1.041), (I-655)+(1.026)+(1.042), (I-655)+(1.026)+(1.043), (I-655)+(1.026)+(1.044), (I-655)+(1.026)+(1.045), (I-655)+(1.026)+(1.046), (I-655)+(1.026)+(1.047), (I-655)+(1.026)+(1.048), (I-655)+(1.026)+(1.049), (I-655)+(1.026)+(1.050), (I-655)+(1.026)+(1.051), (I-655)+(1.026)+(1.052), (I-655)+(1.026)+(1.053), (I-655)+(1.026)+(1.054), (I-655)+(1.026)+(1.055), (I-655)+(1.026)+(1.056), (I-655)+(1.026)+(1.057), (I-655)+(1.026)+(1.058), (I-655)+(1.026)+(1.059), (I-655)+(1.026)+(1.060), (I-655)+(1.026)+(1.061), (I-655)+(1.026)+(1.062), (I-655)+(1.026)+(1.063), (I-655)+(1.026)+(1.064), (I-655)+(1.026)+(1.065), (I-655)+(1.026)+(1.066), (I-655)+(1.026)+(1.067), (I-655)+(1.026)+(1.068), (I-655)+(1.026)+(1.069), (I-655)+(1.026)+(1.070), (I-655)+(1.026)+(1.071), (I-655)+(1.026)+(1.072), (I-655)+(1.026)+(1.073), (I-655)+(1.026)+(1.074), (I-655)+(1.026)+(1.075), (I-655)+(1.026)+(1.076), (I-655)+(1.026)+(1.077), (I-655)+(1.026)+(1.078), (I-655)+(1.026)+(1.079), (I-655)+(1.026)+(1.080), (I-655)+(1.026)+(1.081), (I-655)+(1.026)+(1.082), (I-655)+(1.026)+(1.083), (I-655)+(1.026)+(1.084), (I-655)+(1.026)+(1.085), (I-655)+(1.026)+(1.086), (I-655)+(1.026)+(1.087), (I-655)+(1.026)+(1.088), (I-655)+(1.026)+(1.089), (I-655)+(1.026)+(1.090), (I-655)+(1.026)+(1.091), (I-655)+(1.026)+(1.092), (I-655)+(1.026)+(2.001), (I-655)+(1.026)+(2.002), (I-655)+(1.026)+(2.003), (I-655)+(1.026)+(2.004), (I-655)+(1.026)+(2.005), (I-655)+(1.026)+(2.006), (I-655)+(1.026)+(2.007), (I-655)+(1.026)+(2.008), (I-655)+(1.026)+(2.009), (I-655)+(1.026)+(2.010), (I-655)+(1.026)+(2.011), (I-655)+(1.026)+(2.012), (I-655)+(1.026)+(2.013), (I-655)+(1.026)+(2.014), (I-655)+(1.026)+(2.015), (I-655)+(1.026)+(2.016), (I-655)+(1.026)+(2.017), (I-655)+(1.026)+(2.018), (I-655)+(1.026)+(2.019), (I-655)+(1.026)+(2.020), (I-655)+(1.026)+(2.021), (I-655)+(1.026)+(2.022), (I-655)+(1.026)+(2.023), (I-655)+(1.026)+(2.024), (I-655)+(1.026)+(2.025), (I-655)+(1.026)+(2.026), (I-655)+(1.026)+(2.027), (I-655)+(1.026)+(2.028), (I-655)+(1.026)+(2.029), (I-655)+(1.026)+(2.030), (I-655)+(1.026)+(2.031), (I-655)+(1.026)+(2.032), (I-655)+(1.026)+(2.033), (I-655)+(1.026)+(2.034), (I-655)+(1.026)+(2.035), (I-655)+(1.026)+(2.036), (I-655)+(1.026)+(2.037), (I-655)+(1.026)+(2.038), (I-655)+(1.026)+(2.039), (I-655)+(1.026)+(2.040), (I-655)+(1.026)+(2.041), (I-655)+(1.026)+(2.042), (I-655)+(1.026)+(2.043), (I-655)+(1.026)+(2.044), (I-655)+(1.026)+(2.045), (I-655)+(1.026)+(2.046), (I-655)+(1.026)+(2.047), (I-655)+(1.026)+(2.048), (I-655)+(1.026)+(2.049), (I-655)+(1.026)+(2.050), (I-655)+(1.026)+(2.051), (I-655)+(1.026)+(2.052), (I-655)+(1.026)+(2.053), (I-655)+(1.026)+(2.054), (I-655)+(1.026)+(2.055), (I-655)+(1.026)+(2.056), (I-655)+(1.026)+(2.057), (I-655)+(1.026)+(2.058), (I-655)+(1.026)+(2.059), (I-655)+(1.026)+(3.001), (I-655)+(1.026)+(3.002), (I-655)+(1.026)+(3.003), (I-655)+(1.026)+(3.004), (I-655)+(1.026)+(3.005), (I-655)+(1.026)+(3.006), (I-655)+(1.026)+(3.007), (I-655)+(1.026)+(3.008), (I-655)+(1.026)+(3.009), (I-655)+(1.026)+(3.010), (I-655)+(1.026)+(3.011), (I-655)+(1.026)+(3.012), (I-655)+(1.026)+(3.013), (I-655)+(1.026)+(3.014), (I-655)+(1.026)+(3.015), (I-655)+(1.026)+(3.016), (I-655)+(1.026)+(3.017), (I-655)+(1.026)+(3.018), (I-655)+(1.026)+(3.019), (I-655)+(1.026)+(3.020), (I-655)+(1.026)+(3.021), (I-655)+(1.026)+(3.022), (I-655)+(1.026)+(3.023), (I-655)+(1.026)+(3.024), (I-655)+(1.026)+(3.025), (I-655)+(1.026)+(3.026), (I-655)+(1.026)+(3.027), (I-655)+(1.026)+(3.028), (I-655)+(1.026)+(3.029), (I-655)+(1.026)+(3.030), (I-655)+(1.026)+(3.031), (I-655)+(1.026)+(5.001), (I-655)+(1.026)+(5.002), (I-655)+(1.026)+(5.003), (I-655)+(1.026)+(5.004), (I-655)+(1.026)+(5.005), (I-655)+(1.026)+(5.006), (I-655)+(1.026)+(5.007), (I-655)+(1.026)+(5.008), (I-655)+(1.026)+(5.009), (I-655)+(1.026)+(5.010), (I-655)+(1.026)+(5.011), (I-655)+(1.026)+(5.012), (I-655)+(1.026)+(5.013), (I-655)+(1.026)+(5.014), (I-655)+(1.026)+(5.015), (I-655)+(1.026)+(5.016), (I-655)+(1.026)+(5.017), (I-655)+(1.026)+(5.018), (I-655)+(1.026)+(5.019), (I-655)+(1.026)+(5.020), (I-655)+(1.026)+(5.021), (I-655)+(1.026)+(5.022), (I-655)+(1.026)+(5.023), (I-655)+(1.026)+(6.001), (I-655)+(1.026)+(6.002), (I-655)+(1.026)+(6.003), (I-655)+(1.026)+(6.004), (I-655)+(1.026)+(7.001), (I-655)+(1.026)+(7.002), (I-655)+(1.026)+(7.003), (I-655)+(1.026)+(7.004), (I-655)+(1.026)+(7.005), (I-655)+(1.026)+(7.006), (I-655)+(1.026)+(9.001), (I-655)+(1.026)+(9.002), (I-655)+(1.026)+(9.003), (I-655)+(1.026)+(9.004), (I-655)+(1.026)+(9.005), (I-655)+(1.026)+(9.006), (I-655)+(1.026)+(9.007), (I-655)+(1.026)+(9.008), (I-655)+(1.026)+(9.009), (I-655)+(1.026)+(14.001), (I-655)+(1.026)+(14.002), (I-655)+(1.026)+(15.008), (I-655)+(1.026)+(15.011), (I-655)+(1.026)+(15.012), (I-655)+(1.026)+(15.016), (I-655)+(1.026)+(15.025), (I-655)+(1.026)+(15.027), (I-655)+(1.026)+(15.047), (I-655)+(1.026)+(15.063), (I-655)+(1.026)+(15.064), (I-655)+(1.026)+(16.001), (I-655)+(1.026)+(16.002), (I-655)+(1.026)+(16.003), (I-655)+(1.026)+(16.004), (I-655)+(1.026)+(16.005), (I-655)+(1.026)+(16.006), (I-655)+(1.026)+(16.007), (I-655)+(1.026)+(16.008), (I-655)+(1.026)+(17.001), (I-655)+(1.026)+(17.002), (I-655)+(1.026)+(17.003), (I-655)+(1.026)+(17.004), (I-655)+(1.026)+(17.005), (I-655)+(1.026)+(17.006), (I-655)+(1.026)+(17.007), (I-655)+(1.026)+(17.008), (I-655)+(1.026)+(17.009), (I-655)+(1.026)+(17.010), (I-655)+(1.026)+(17.011), (I-655)+(1.026)+(17.012), (I-655)+(1.026)+(18.001),

(I-655)+(1.027)+(1.028), (I-655)+(1.027)+(1.029), (I-655)+(1.027)+(1.030), (I-655)+(1.027)+(1.031), (I-655)+(1.027)+(1.032), (I-655)+(1.027)+(1.033), (I-655)+(1.027)+(1.034), (I-655)+(1.027)+(1.035), (I-655)+(1.027)+(1.036), (I-655)+(1.027)+(1.037), (I-655)+(1.027)+(1.038), (I-655)+(1.027)+(1.039), (I-655)+(1.027)+(1.040), (I-655)+(1.027)+(1.041), (I-655)+(1.027)+(1.042), (I-655)+(1.027)+(1.043), (I-655)+(1.027)+(1.044), (I-655)+(1.027)+(1.045), (I-655)+(1.027)+(1.046), (I-655)+(1.027)+(1.047), (I-655)+(1.027)+(1.048), (I-655)+(1.027)+(1.049), (I-655)+(1.027)+(1.050), (I-655)+(1.027)+(1.051), (I-655)+(1.027)+(1.052), (I-655)+(1.027)+(1.053), (I-655)+(1.027)+(1.054), (I-655)+(1.027)+(1.055), (I-655)+(1.027)+(1.056), (I-655)+(1.027)+(1.057), (I-655)+(1.027)+(1.058), (I-655)+(1.027)+(1.059), (I-655)+(1.027)+(1.060), (I-655)+(1.027)+(1.061), (I-655)+(1.027)+(1.062), (I-655)+(1.027)+(1.063), (I-655)+(1.027)+(1.064), (I-655)+(1.027)+(1.065), (I-655)+(1.027)+(1.066), (I-655)+(1.027)+(1.067), (I-655)+(1.027)+(1.068), (I-655)+(1.027)+(1.069), (I-655)+(1.027)+(1.070), (I-655)+(1.027)+(1.071), (I-655)+(1.027)+(1.072), (I-655)+(1.027)+(1.073), (I-655)+(1.027)+(1.074), (I-655)+(1.027)+(1.075), (I-655)+(1.027)+(1.076), (I-655)+(1.027)+(1.077), (I-655)+(1.027)+(1.078), (I-655)+(1.027)+(1.079), (I-655)+(1.027)+(1.080), (I-655)+(1.027)+(1.081), (I-655)+(1.027)+(1.082), (I-655)+(1.027)+(1.083), (I-655)+(1.027)+(1.084), (I-655)+(1.027)+(1.085), (I-655)+(1.027)+(1.086), (I-655)+(1.027)+(1.087), (I-655)+(1.027)+(1.088), (I-655)+(1.027)+(1.089), (I-655)+(1.027)+(1.090), (I-655)+(1.027)+(1.091), (I-655)+(1.027)+(1.092), (I-655)+(1.027)+(2.001), (I-655)+(1.027)+(2.002), (I-655)+(1.027)+(2.003), (I-655)+(1.027)+(2.004), (I-655)+(1.027)+(2.005), (I-655)+(1.027)+(2.006), (I-655)+(1.027)+(2.007), (I-655)+(1.027)+(2.008), (I-655)+(1.027)+(2.009), (I-655)+(1.027)+(2.010), (I-655)+(1.027)+(2.011), (I-655)+(1.027)+(2.012), (I-655)+(1.027)+(2.013), (I-655)+(1.027)+(2.014), (I-655)+(1.027)+(2.015), (I-655)+(1.027)+(2.016), (I-655)+(1.027)+(2.017), (I-655)+(1.027)+(2.018), (I-655)+(1.027)+(2.019), (I-655)+(1.027)+(2.020), (I-655)+(1.027)+(2.021), (I-655)+(1.027)+(2.022), (I-655)+(1.027)+(2.023), (I-655)+(1.027)+(2.024), (I-655)+(1.027)+(2.025), (I-655)+(1.027)+(2.026), (I-655)+(1.027)+(2.027), (I-655)+(1.027)+(2.028), (I-655)+(1.027)+(2.029), (I-655)+(1.027)+(2.030), (I-655)+(1.027)+(2.031), (I-655)+(1.027)+(2.032), (I-655)+(1.027)+(2.033), (I-655)+(1.027)+(2.034), (I-655)+(1.027)+(2.035), (I-655)+(1.027)+(2.036), (I-655)+(1.027)+(2.037), (I-655)+(1.027)+(2.038), (I-655)+(1.027)+(2.039), (I-655)+(1.027)+(2.040), (I-655)+(1.027)+(2.041), (I-655)+(1.027)+(2.042), (I-655)+(1.027)+(2.043), (I-655)+(1.027)+(2.044), (I-655)+(1.027)+(2.045), (I-655)+(1.027)+(2.046), (I-655)+(1.027)+(2.047), (I-655)+(1.027)+(2.048), (I-655)+(1.027)+(2.049), (I-655)+(1.027)+(2.050), (I-655)+(1.027)+(2.051), (I-655)+(1.027)+(2.052), (I-655)+(1.027)+(2.053), (I-655)+(1.027)+(2.054), (I-655)+(1.027)+(2.055), (I-655)+(1.027)+(2.056), (I-655)+(1.027)+(2.057), (I-655)+(1.027)+(2.058), (I-655)+(1.027)+(2.059), (I-655)+(1.027)+(3.001), (I-655)+(1.027)+(3.002), (I-655)+(1.027)+(3.003), (I-655)+(1.027)+(3.004), (I-655)+(1.027)+(3.005), (I-655)+(1.027)+(3.006), (I-655)+(1.027)+(3.007), (I-655)+(1.027)+(3.008), (I-655)+(1.027)+(3.009), (I-655)+(1.027)+(3.010), (I-655)+(1.027)+(3.011), (I-655)+(1.027)+(3.012), (I-655)+(1.027)+(3.013), (I-655)+(1.027)+(3.014), (I-655)+(1.027)+(3.015), (I-655)+(1.027)+(3.016), (I-655)+(1.027)+(3.017), (I-655)+(1.027)+(3.018), (I-655)+(1.027)+(3.019), (I-655)+(1.027)+(3.020), (I-655)+(1.027)+(3.021), (I-655)+(1.027)+(3.022), (I-655)+(1.027)+(3.023), (I-655)+(1.027)+(3.024), (I-655)+(1.027)+(3.025), (I-655)+(1.027)+(3.026), (I-655)+(1.027)+(3.027), (I-655)+(1.027)+(3.028), (I-655)+(1.027)+(3.029), (I-655)+(1.027)+(3.030), (I-655)+(1.027)+(3.031), (I-655)+(1.027)+(5.001), (I-655)+(1.027)+(5.002), (I-655)+(1.027)+(5.003), (I-655)+(1.027)+(5.004), (I-655)+(1.027)+(5.005), (I-655)+(1.027)+(5.006), (I-655)+(1.027)+(5.007), (I-655)+(1.027)+(5.008), (I-655)+(1.027)+(5.009), (I-655)+(1.027)+(5.010), (I-655)+(1.027)+(5.011), (I-655)+(1.027)+(5.012), (I-655)+(1.027)+(5.013), (I-655)+(1.027)+(5.014), (I-655)+(1.027)+(5.015), (I-655)+(1.027)+(5.016), (I-655)+(1.027)+(5.017), (I-655)+(1.027)+(5.018), (I-655)+(1.027)+(5.019), (I-655)+(1.027)+(5.020), (I-655)+(1.027)+(5.021), (I-655)+(1.027)+(5.022), (I-655)+(1.027)+(5.023), (I-655)+(1.027)+(6.001), (I-655)+(1.027)+(6.002), (I-655)+(1.027)+(6.003), (I-655)+(1.027)+(6.004), (I-655)+(1.027)+(7.001), (I-655)+(1.027)+(7.002), (I-655)+(1.027)+(7.003), (I-655)+(1.027)+(7.004), (I-655)+(1.027)+(7.005), (I-655)+(1.027)+(7.006), (I-655)+(1.027)+(9.001), (I-655)+(1.027)+(9.002), (I-655)+(1.027)+(9.003), (I-655)+(1.027)+(9.004), (I-655)+(1.027)+(9.005), (I-655)+(1.027)+(9.006), (I-655)+(1.027)+(9.007), (I-655)+(1.027)+(9.008), (I-655)+(1.027)+(9.009), (I-655)+(1.027)+(14.001), (I-655)+(1.027)+(14.002), (I-655)+(1.027)+(15.008), (I-655)+(1.027)+(15.011), (I-655)+(1.027)+(15.012), (I-655)+(1.027)+(15.016), (I-655)+(1.027)+(15.025), (I-655)+(1.027)+(15.027), (I-655)+(1.027)+(15.047), (I-655)+(1.027)+(15.063), (I-655)+(1.027)+(15.064), (I-655)+(1.027)+(16.001), (I-655)+(1.027)+(16.002), (I-655)+(1.027)+(16.003), (I-655)+(1.027)+(16.004), (I-655)+(1.027)+(16.005), (I-655)+(1.027)+(16.006), (I-655)+(1.027)+(16.007), (I-655)+(1.027)+(16.008), (I-655)+(1.027)+(17.001), (I-655)+(1.027)+(17.002), (I-655)+(1.027)+(17.003), (I-655)+(1.027)+(17.004), (I-655)+(1.027)+(17.005), (I-655)+(1.027)+(17.006), (I-655)+(1.027)+(17.007), (I-655)+(1.027)+(17.008), (I-655)+(1.027)+(17.009), (I-655)+(1.027)+(17.010), (I-655)+(1.027)+(17.011), (I-655)+(1.027)+(17.012), (I-655)+(1.027)+(18.001),

(I-655)+(1.028)+(1.029), (I-655)+(1.028)+(1.030), (I-655)+(1.028)+(1.031), (I-655)+(1.028)+(1.032), (I-655)+(1.028)+(1.033), (I-655)+(1.028)+(1.034), (I-655)+(1.028)+(1.035), (I-655)+(1.028)+(1.036), (I-655)+(1.028)+(1.037), (I-655)+(1.028)+(1.038), (I-655)+(1.028)+(1.039), (I-655)+(1.028)+(1.040), (I-655)+(1.028)+(1.041), (I-655)+(1.028)+(1.042), (I-655)+(1.028)+(1.043), (I-655)+(1.028)+(1.044), (I-655)+(1.028)+(1.045), (I-655)+(1.028)+(1.046), (I-655)+(1.028)+(1.047), (I-655)+(1.028)+(1.048), (I-655)+(1.028)+(1.049), (I-655)+(1.028)+(1.050), (I-655)+(1.028)+(1.051), (I-655)+(1.028)+(1.052), (I-655)+(1.028)+(1.053), (I-655)+(1.028)+(1.054), (I-655)+(1.028)+(1.055), (I-655)+(1.028)+(1.056), (I-655)+(1.028)+(1.057), (I-655)+(1.028)+(1.058), (I-655)+(1.028)+(1.059), (I-655)+(1.028)+(1.060), (I-655)+(1.028)+(1.061), (I-655)+(1.028)+(1.062), (I-655)+(1.028)+(1.063), (I-655)+(1.028)+(1.064), (I-655)+(1.028)+(1.065), (I-655)+(1.028)+(1.066), (I-655)+(1.028)+(1.067), (I-655)+(1.028)+(1.068), (I-655)+(1.028)+(1.069), (I-655)+(1.028)+(1.070), (I-655)+(1.028)+(1.071), (I-655)+(1.028)+(1.072), (I-655)+(1.028)+(1.073), (I-655)+(1.028)+(1.074), (I-655)+(1.028)+(1.075), (I-655)+(1.028)+(1.076), (I-655)+(1.028)+(1.077), (I-655)+(1.028)+(1.078), (I-655)+(1.028)+(1.079), (I-655)+(1.028)+(1.080), (I-655)+(1.028)+(1.081), (I-655)+(1.028)+(1.082), (I-655)+(1.028)+(1.083), (I-655)+(1.028)+(1.084), (I-655)+(1.028)+(1.085), (I-655)+(1.028)+(1.086), (I-655)+(1.028)+(1.087), (I-655)+(1.028)+(1.088), (I-655)+(1.028)+(1.089), (I-655)+(1.028)+(1.090), (I-655)+(1.028)+(1.091), (I-655)+(1.028)+(1.092), (I-655)+(1.028)+(2.001), (I-655)+(1.028)+(2.002), (I-655)+(1.028)+(2.003), (I-655)+(1.028)+(2.004), (I-655)+(1.028)+(2.005), (I-655)+(1.028)+(2.006), (I-655)+(1.028)+(2.007), (I-655)+(1.028)+(2.008), (I-655)+(1.028)+(2.009), (I-655)+(1.028)+(2.010), (I-655)+(1.028)+(2.011), (I-655)+(1.028)+(2.012), (I-655)+(1.028)+(2.013), (I-655)+(1.028)+(2.014), (I-655)+(1.028)+(2.015), (I-655)+(1.028)+(2.016), (I-655)+(1.028)+(2.017), (I-655)+(1.028)+(2.018), (I-655)+(1.028)+(2.019), (I-655)+(1.028)+(2.020), (I-655)+(1.028)+(2.021), (I-655)+(1.028)+(2.022), (I-655)+(1.028)+(2.023), (I-655)+(1.028)+(2.024), (I-655)+(1.028)+(2.025), (I-655)+(1.028)+(2.026), (I-655)+(1.028)+(2.027), (I-655)+(1.028)+(2.028), (I-655)+(1.028)+(2.029), (I-655)+(1.028)+(2.030), (I-655)+(1.028)+(2.031), (I-655)+(1.028)+(2.032), (I-655)+(1.028)+(2.033), (I-655)+(1.028)+(2.034), (I-655)+(1.028)+(2.035), (I-655)+(1.028)+(2.036), (I-655)+(1.028)+(2.037), (I-655)+(1.028)+(2.038), (I-655)+(1.028)+(2.039), (I-655)+(1.028)+(2.040), (I-655)+(1.028)+(2.041), (I-655)+(1.028)+(2.042), (I-655)+(1.028)+(2.043), (I-655)+(1.028)+(2.044), (I-655)+(1.028)+(2.045), (I-655)+(1.028)+(2.046), (I-655)+(1.028)+(2.047), (I-655)+(1.028)+(2.048), (I-655)+(1.028)+(2.049), (I-655)+(1.028)+(2.050), (I-655)+(1.028)+(2.051), (I-655)+(1.028)+(2.052), (I-655)+(1.028)+(2.053), (I-655)+(1.028)+(2.054), (I-655)+(1.028)+(2.055), (I-655)+(1.028)+(2.056), (I-655)+(1.028)+(2.057), (I-655)+(1.028)+(2.058), (I-655)+(1.028)+(2.059), (I-655)+(1.028)+(3.001), (I-655)+(1.028)+(3.002), (I-655)+(1.028)+(3.003), (I-655)+(1.028)+(3.004), (I-655)+(1.028)+(3.005), (I-655)+(1.028)+(3.006), (I-655)+(1.028)+(3.007), (I-655)+(1.028)+(3.008), (I-655)+(1.028)+(3.009), (I-655)+(1.028)+(3.010), (I-655)+(1.028)+(3.011), (I-655)+(1.028)+(3.012), (I-655)+(1.028)+(3.013), (I-655)+(1.028)+(3.014), (I-655)+(1.028)+(3.015), (I-655)+(1.028)+(3.016), (I-655)+(1.028)+(3.017), (I-655)+(1.028)+(3.018), (I-655)+(1.028)+(3.019), (I-655)+(1.028)+(3.020), (I-655)+(1.028)+(3.021), (I-655)+(1.028)+(3.022), (I-655)+(1.028)+(3.023), (I-655)+(1.028)+(3.024), (I-655)+(1.028)+(3.025), (I-655)+(1.028)+(3.026), (I-655)+(1.028)+(3.027), (I-655)+(1.028)+(3.028), (I-655)+(1.028)+(3.029), (I-655)+(1.028)+(3.030), (I-655)+(1.028)+(3.031), (I-655)+(1.028)+(5.001), (I-655)+(1.028)+(5.002), (I-655)+(1.028)+(5.003), (I-655)+(1.028)+(5.004), (I-655)+(1.028)+(5.005), (I-655)+(1.028)+(5.006), (I-655)+(1.028)+(5.007), (I-655)+(1.028)+(5.008), (I-655)+(1.028)+(5.009), (I-655)+(1.028)+(5.010), (I-655)+(1.028)+(5.011), (I-655)+(1.028)+(5.012), (I-655)+(1.028)+(5.013), (I-655)+(1.028)+(5.014), (I-655)+(1.028)+(5.015), (I-655)+(1.028)+(5.016), (I-655)+(1.028)+(5.017), (I-655)+(1.028)+(5.018), (I-655)+(1.028)+(5.019), (I-655)+(1.028)+(5.020), (I-655)+(1.028)+(5.021), (I-655)+(1.028)+(5.022), (I-655)+(1.028)+(5.023), (I-655)+(1.028)+(6.001), (I-655)+(1.028)+(6.002), (I-655)+(1.028)+(6.003), (I-655)+(1.028)+(6.004), (I-655)+(1.028)+(7.001), (I-655)+(1.028)+(7.002), (I-655)+(1.028)+(7.003), (I-655)+(1.028)+(7.004), (I-655)+(1.028)+(7.005), (I-655)+(1.028)+(7.006), (I-655)+(1.028)+(9.001), (I-655)+(1.028)+(9.002), (I-655)+(1.028)+(9.003), (I-655)+(1.028)+(9.004), (I-655)+(1.028)+(9.005), (I-655)+(1.028)+(9.006), (I-655)+(1.028)+(9.007), (I-655)+(1.028)+(9.008), (I-655)+(1.028)+(9.009), (I-655)+(1.028)+(14.001), (I-655)+(1.028)+(14.002), (I-655)+(1.028)+(15.008), (I-655)+(1.028)+(15.011), (I-655)+(1.028)+(15.012), (I-655)+(1.028)+(15.016), (I-655)+(1.028)+(15.025), (I-655)+(1.028)+(15.027), (I-655)+(1.028)+(15.047), (I-655)+(1.028)+(15.063), (I-655)+(1.028)+(15.064), (I-655)+(1.028)+(16.001), (I-655)+(1.028)+(16.002), (I-655)+(1.028)+(16.003), (I-655)+(1.028)+(16.004), (I-655)+(1.028)+(16.005), (I-655)+(1.028)+(16.006), (I-655)+(1.028)+(16.007), (I-655)+(1.028)+(16.008), (I-655)+(1.028)+(17.001), (I-655)+(1.028)+(17.002), (I-655)+(1.028)+(17.003), (I-655)+(1.028)+(17.004), (I-655)+(1.028)+(17.005), (I-655)+(1.028)+(17.006), (I-655)+(1.028)+(17.007), (I-655)+(1.028)+(17.008), (I-655)+(1.028)+(17.009), (I-655)+(1.028)+(17.010), (I-655)+(1.028)+(17.011), (I-655)+(1.028)+(17.012), (I-655)+(1.028)+(18.001),

(I-655)+(1.029)+(1.030), (I-655)+(1.029)+(1.031), (I-655)+(1.029)+(1.032), (I-655)+(1.029)+(1.033), (I-655)+(1.029)+(1.034), (I-655)+(1.029)+(1.035), (I-655)+(1.029)+(1.036), (I-655)+(1.029)+(1.037), (I-655)+(1.029)+(1.038), (I-655)+(1.029)+(1.039), (I-655)+(1.029)+(1.040), (I-655)+(1.029)+(1.041), (I-655)+(1.029)+(1.042), (I-655)+(1.029)+(1.043), (I-655)+(1.029)+(1.044), (I-655)+(1.029)+(1.045), (I-655)+(1.029)+(1.046), (I-655)+(1.029)+(1.047), (I-655)+(1.029)+(1.048), (I-655)+(1.029)+(1.049), (I-655)+(1.029)+(1.050), (I-655)+(1.029)+(1.051), (I-655)+(1.029)+(1.052), (I-655)+(1.029)+(1.053), (I-655)+(1.029)+(1.054), (I-655)+(1.029)+(1.055), (I-655)+(1.029)+(1.056), (I-655)+(1.029)+(1.057), (I-655)+(1.029)+(1.058), (I-655)+(1.029)+(1.059), (I-655)+(1.029)+(1.060), (I-655)+(1.029)+(1.061), (I-655)+(1.029)+(1.062), (I-655)+(1.029)+(1.063), (I-655)+(1.029)+(1.064), (I-655)+(1.029)+(1.065), (I-655)+(1.029)+(1.066), (I-655)+(1.029)+(1.067), (I-655)+(1.029)+(1.068), (I-655)+(1.029)+(1.069), (I-655)+(1.029)+(1.070), (I-655)+(1.029)+(1.071), (I-655)+(1.029)+(1.072), (I-655)+(1.029)+(1.073), (I-655)+(1.029)+(1.074), (I-655)+(1.029)+(1.075), (I-655)+(1.029)+(1.076), (I-655)+(1.029)+(1.077), (I-655)+(1.029)+(1.078), (I-655)+(1.029)+(1.079), (I-655)+(1.029)+(1.080), (I-655)+(1.029)+(1.081), (I-655)+(1.029)+(1.082), (I-655)+(1.029)+(1.083), (I-655)+(1.029)+(1.084), (I-655)+(1.029)+(1.085), (I-655)+(1.029)+(1.086), (I-655)+(1.029)+(1.087), (I-655)+(1.029)+(1.088), (I-655)+(1.029)+(1.089), (I-655)+(1.029)+(1.090), (I-655)+(1.029)+(1.091), (I-655)+(1.029)+(1.092), (I-655)+(1.029)+(2.001), (I-655)+(1.029)+(2.002), (I-655)+(1.029)+(2.003), (I-655)+(1.029)+(2.004), (I-655)+(1.029)+(2.005), (I-655)+(1.029)+(2.006), (I-655)+(1.029)+(2.007), (I-655)+(1.029)+(2.008), (I-655)+(1.029)+(2.009), (I-655)+(1.029)+(2.010), (I-655)+(1.029)+(2.011), (I-655)+(1.029)+(2.012), (I-655)+(1.029)+(2.013), (I-655)+(1.029)+(2.014), (I-655)+(1.029)+(2.015), (I-655)+(1.029)+(2.016), (I-655)+(1.029)+(2.017), (I-655)+(1.029)+(2.018), (I-655)+(1.029)+(2.019), (I-655)+(1.029)+(2.020), (I-655)+(1.029)+(2.021), (I-655)+(1.029)+(2.022), (I-655)+(1.029)+(2.023), (I-655)+(1.029)+(2.024), (I-655)+(1.029)+(2.025), (I-655)+(1.029)+(2.026), (I-655)+(1.029)+(2.027), (I-655)+(1.029)+(2.028), (I-655)+(1.029)+(2.029), (I-655)+(1.029)+(2.030), (I-655)+(1.029)+(2.031), (I-655)+(1.029)+(2.032), (I-655)+(1.029)+(2.033), (I-655)+(1.029)+(2.034), (I-655)+(1.029)+(2.035), (I-655)+(1.029)+(2.036), (I-655)+(1.029)+(2.037), (I-655)+(1.029)+(2.038), (I-655)+(1.029)+(2.039), (I-655)+(1.029)+(2.040), (I-655)+(1.029)+(2.041), (I-655)+(1.029)+(2.042), (I-655)+(1.029)+(2.043), (I-655)+(1.029)+(2.044), (I-655)+(1.029)+(2.045), (I-655)+(1.029)+(2.046), (I-655)+(1.029)+(2.047), (I-655)+(1.029)+(2.048), (I-655)+(1.029)+(2.049), (I-655)+(1.029)+(2.050), (I-655)+(1.029)+(2.051), (I-655)+(1.029)+(2.052), (I-655)+(1.029)+(2.053), (I-655)+(1.029)+(2.054), (I-655)+(1.029)+(2.055), (I-655)+(1.029)+(2.056), (I-655)+(1.029)+(2.057), (I-655)+(1.029)+(2.058), (I-655)+(1.029)+(2.059), (I-655)+(1.029)+(3.001), (I-655)+(1.029)+(3.002), (I-655)+(1.029)+(3.003), (I-655)+(1.029)+(3.004), (I-655)+(1.029)+(3.005), (I-655)+(1.029)+(3.006), (I-655)+(1.029)+(3.007), (I-655)+(1.029)+(3.008), (I-655)+(1.029)+(3.009), (I-655)+(1.029)+(3.010), (I-655)+(1.029)+(3.011), (I-655)+(1.029)+(3.012), (I-655)+(1.029)+(3.013), (I-655)+(1.029)+(3.014), (I-655)+(1.029)+(3.015), (I-655)+(1.029)+(3.016), (I-655)+(1.029)+(3.017), (I-655)+(1.029)+(3.018), (I-655)+(1.029)+(3.019), (I-655)+(1.029)+(3.020), (I-655)+(1.029)+(3.021), (I-655)+(1.029)+(3.022), (I-655)+(1.029)+(3.023), (I-655)+(1.029)+(3.024), (I-655)+(1.029)+(3.025), (I-655)+(1.029)+(3.026), (I-655)+(1.029)+(3.027), (I-655)+(1.029)+(3.028), (I-655)+(1.029)+(3.029), (I-655)+(1.029)+(3.030), (I-655)+(1.029)+(3.031), (I-655)+(1.029)+(5.001), (I-655)+(1.029)+(5.002), (I-655)+(1.029)+(5.003), (I-655)+(1.029)+(5.004), (I-655)+(1.029)+(5.005), (I-655)+(1.029)+(5.006), (I-655)+(1.029)+(5.007), (I-655)+(1.029)+(5.008), (I-655)+(1.029)+(5.009), (I-655)+(1.029)+(5.010), (I-655)+(1.029)+(5.011), (I-655)+(1.029)+(5.012), (I-655)+(1.029)+(5.013), (I-655)+(1.029)+(5.014), (I-655)+(1.029)+(5.015), (I-655)+(1.029)+(5.016), (I-655)+(1.029)+(5.017), (I-655)+(1.029)+(5.018), (I-655)+(1.029)+(5.019), (I-655)+(1.029)+(5.020), (I-655)+(1.029)+(5.021), (I-655)+(1.029)+(5.022), (I-655)+(1.029)+(5.023), (I-655)+(1.029)+(6.001), (I-655)+(1.029)+(6.002), (I-655)+(1.029)+(6.003), (I-655)+(1.029)+(6.004), (I-655)+(1.029)+(7.001), (I-655)+(1.029)+(7.002), (I-655)+(1.029)+(7.003), (I-655)+(1.029)+(7.004), (I-655)+(1.029)+(7.005), (I-655)+(1.029)+(7.006), (I-655)+(1.029)+(9.001), (I-655)+(1.029)+(9.002), (I-655)+(1.029)+(9.003), (I-655)+(1.029)+(9.004), (I-655)+(1.029)+(9.005), (I-655)+(1.029)+(9.006), (I-655)+(1.029)+(9.007), (I-655)+(1.029)+(9.008), (I-655)+(1.029)+(9.009), (I-655)+(1.029)+(14.001), (I-655)+(1.029)+(14.002), (I-655)+(1.029)+(15.008), (I-655)+(1.029)+(15.011), (I-655)+(1.029)+(15.012), (I-655)+(1.029)+(15.016), (I-655)+(1.029)+(15.025), (I-655)+(1.029)+(15.027), (I-655)+(1.029)+(15.047), (I-655)+(1.029)+(15.063), (I-655)+(1.029)+(15.064), (I-655)+(1.029)+(16.001), (I-655)+(1.029)+(16.002), (I-655)+(1.029)+(16.003), (I-655)+(1.029)+(16.004), (I-655)+(1.029)+(16.005), (I-655)+(1.029)+(16.006), (I-655)+(1.029)+(16.007), (I-655)+(1.029)+(16.008), (I-655)+(1.029)+(17.001), (I-655)+(1.029)+(17.002), (I-655)+(1.029)+(17.003), (I-655)+(1.029)+(17.004), (I-655)+(1.029)+(17.005), (I-655)+(1.029)+(17.006), (I-655)+(1.029)+(17.007), (I-655)+(1.029)+(17.008), (I-655)+(1.029)+(17.009), (I-655)+(1.029)+(17.010), (I-655)+(1.029)+(17.011), (I-655)+(1.029)+(17.012), (I-655)+(1.029)+(18.001),

(I-655)+(1.030)+(1.031), (I-655)+(1.030)+(1.032), (I-655)+(1.030)+(1.033), (I-655)+(1.030)+(1.034), (I-655)+(1.030)+(1.035), (I-655)+(1.030)+(1.036), (I-655)+(1.030)+(1.037), (I-655)+(1.030)+(1.038), (I-655)+(1.030)+(1.039), (I-655)+(1.030)+(1.040), (I-655)+(1.030)+(1.041), (I-655)+(1.030)+(1.042), (I-655)+(1.030)+(1.043), (I-655)+(1.030)+(1.044), (I-655)+(1.030)+(1.045), (I-655)+(1.030)+(1.046), (I-655)+(1.030)+(1.047), (I-655)+(1.030)+(1.048), (I-655)+(1.030)+(1.049), (I-655)+(1.030)+(1.050), (I-655)+(1.030)+(1.051), (I-655)+(1.030)+(1.052), (I-655)+(1.030)+(1.053), (I-655)+(1.030)+(1.054), (I-655)+(1.030)+(1.055), (I-655)+(1.030)+(1.056), (I-655)+(1.030)+(1.057), (I-655)+(1.030)+(1.058), (I-655)+(1.030)+(1.059), (I-655)+(1.030)+(1.060), (I-655)+(1.030)+(1.061), (I-655)+(1.030)+(1.062), (I-655)+(1.030)+(1.063), (I-655)+(1.030)+(1.064), (I-655)+(1.030)+(1.065), (I-655)+(1.030)+(1.066), (I-655)+(1.030)+(1.067), (I-655)+(1.030)+(1.068), (I-655)+(1.030)+(1.069), (I-655)+(1.030)+(1.070), (I-655)+(1.030)+(1.071), (I-655)+(1.030)+(1.072), (I-655)+(1.030)+(1.073), (I-655)+(1.030)+(1.074), (I-655)+(1.030)+(1.075), (I-655)+(1.030)+(1.076), (I-655)+(1.030)+(1.077), (I-655)+(1.030)+(1.078), (I-655)+(1.030)+(1.079), (I-655)+(1.030)+(1.080), (I-655)+(1.030)+(1.081), (I-655)+(1.030)+(1.082), (I-655)+(1.030)+(1.083), (I-655)+(1.030)+(1.084), (I-655)+(1.030)+(1.085), (I-655)+(1.030)+(1.086), (I-655)+(1.030)+(1.087), (I-655)+(1.030)+(1.088), (I-655)+(1.030)+(1.089), (I-655)+(1.030)+(1.090), (I-655)+(1.030)+(1.091), (I-655)+(1.030)+(1.092), (I-655)+(1.030)+(2.001), (I-655)+(1.030)+(2.002), (I-655)+(1.030)+(2.003), (I-655)+(1.030)+(2.004), (I-655)+(1.030)+(2.005), (I-655)+(1.030)+(2.006), (I-655)+(1.030)+(2.007), (I-655)+(1.030)+(2.008), (I-655)+(1.030)+(2.009), (I-655)+(1.030)+(2.010), (I-655)+(1.030)+(2.011), (I-655)+(1.030)+(2.012), (I-655)+(1.030)+(2.013), (I-655)+(1.030)+(2.014), (I-655)+(1.030)+(2.015), (I-655)+(1.030)+(2.016), (I-655)+(1.030)+(2.017), (I-655)+(1.030)+(2.018), (I-655)+(1.030)+(2.019), (I-655)+(1.030)+(2.020), (I-655)+(1.030)+(2.021), (I-655)+(1.030)+(2.022), (I-655)+(1.030)+(2.023), (I-655)+(1.030)+(2.024), (I-655)+(1.030)+(2.025), (I-655)+(1.030)+(2.026), (I-655)+(1.030)+(2.027), (I-655)+(1.030)+(2.028), (I-655)+(1.030)+(2.029), (I-655)+(1.030)+(2.030), (I-655)+(1.030)+(2.031), (I-655)+(1.030)+(2.032), (I-655)+(1.030)+(2.033), (I-655)+(1.030)+(2.034), (I-655)+(1.030)+(2.035), (I-655)+(1.030)+(2.036), (I-655)+(1.030)+(2.037), (I-655)+(1.030)+(2.038), (I-655)+(1.030)+(2.039), (I-655)+(1.030)+(2.040), (I-655)+(1.030)+(2.041), (I-655)+(1.030)+(2.042), (I-655)+(1.030)+(2.043), (I-655)+(1.030)+(2.044), (I-655)+(1.030)+(2.045), (I-655)+(1.030)+(2.046), (I-655)+(1.030)+(2.047), (I-655)+(1.030)+(2.048), (I-655)+(1.030)+(2.049), (I-655)+(1.030)+(2.050), (I-655)+(1.030)+(2.051), (I-655)+(1.030)+(2.052), (I-655)+(1.030)+(2.053), (I-655)+(1.030)+(2.054), (I-655)+(1.030)+(2.055), (I-655)+(1.030)+(2.056), (I-655)+(1.030)+(2.057), (I-655)+(1.030)+(2.058), (I-655)+(1.030)+(2.059), (I-655)+(1.030)+(3.001), (I-655)+(1.030)+(3.002), (I-655)+(1.030)+(3.003), (I-655)+(1.030)+(3.004), (I-655)+(1.030)+(3.005), (I-655)+(1.030)+(3.006), (I-655)+(1.030)+(3.007), (I-655)+(1.030)+(3.008), (I-655)+(1.030)+(3.009), (I-655)+(1.030)+(3.010), (I-655)+(1.030)+(3.011), (I-655)+(1.030)+(3.012), (I-655)+(1.030)+(3.013), (I-655)+(1.030)+(3.014), (I-655)+(1.030)+(3.015), (I-655)+(1.030)+(3.016), (I-655)+(1.030)+(3.017), (I-655)+(1.030)+(3.018), (I-655)+(1.030)+(3.019), (I-655)+(1.030)+(3.020), (I-655)+(1.030)+(3.021), (I-655)+(1.030)+(3.022), (I-655)+(1.030)+(3.023), (I-655)+(1.030)+(3.024), (I-655)+(1.030)+(3.025), (I-655)+(1.030)+(3.026), (I-655)+(1.030)+(3.027), (I-655)+(1.030)+(3.028), (I-655)+(1.030)+(3.029), (I-655)+(1.030)+(3.030), (I-655)+(1.030)+(3.031), (I-655)+(1.030)+(5.001), (I-655)+(1.030)+(5.002), (I-655)+(1.030)+(5.003), (I-655)+(1.030)+(5.004), (I-655)+(1.030)+(5.005), (I-655)+(1.030)+(5.006), (I-655)+(1.030)+(5.007), (I-655)+(1.030)+(5.008), (I-655)+(1.030)+(5.009), (I-655)+(1.030)+(5.010), (I-655)+(1.030)+(5.011), (I-655)+(1.030)+(5.012), (I-655)+(1.030)+(5.013), (I-655)+(1.030)+(5.014), (I-655)+(1.030)+(5.015), (I-655)+(1.030)+(5.016), (I-655)+(1.030)+(5.017), (I-655)+(1.030)+(5.018), (I-655)+(1.030)+(5.019), (I-655)+(1.030)+(5.020), (I-655)+(1.030)+(5.021), (I-655)+(1.030)+(5.022), (I-655)+(1.030)+(5.023), (I-655)+(1.030)+(6.001), (I-655)+(1.030)+(6.002), (I-655)+(1.030)+(6.003), (I-655)+(1.030)+(6.004), (I-655)+(1.030)+(7.001), (I-655)+(1.030)+(7.002), (I-655)+(1.030)+(7.003), (I-655)+(1.030)+(7.004), (I-655)+(1.030)+(7.005), (I-655)+(1.030)+(7.006), (I-655)+(1.030)+(9.001), (I-655)+(1.030)+(9.002), (I-655)+(1.030)+(9.003), (I-655)+(1.030)+(9.004), (I-655)+(1.030)+(9.005), (I-655)+(1.030)+(9.006), (I-655)+(1.030)+(9.007), (I-655)+(1.030)+(9.008), (I-655)+(1.030)+(9.009), (I-655)+(1.030)+(14.001), (I-655)+(1.030)+(14.002), (I-655)+(1.030)+(15.008), (I-655)+(1.030)+(15.011), (I-655)+(1.030)+(15.012), (I-655)+(1.030)+(15.016), (I-655)+(1.030)+(15.025), (I-655)+(1.030)+(15.027), (I-655)+(1.030)+(15.047), (I-655)+(1.030)+(15.063), (I-655)+(1.030)+(15.064), (I-655)+(1.030)+(16.001), (I-655)+(1.030)+(16.002), (I-655)+(1.030)+(16.003), (I-655)+(1.030)+(16.004), (I-655)+(1.030)+(16.005), (I-655)+(1.030)+(16.006), (I-655)+(1.030)+(16.007), (I-655)+(1.030)+(16.008), (I-655)+(1.030)+(17.001), (I-655)+(1.030)+(17.002), (I-655)+(1.030)+(17.003), (I-655)+(1.030)+(17.004), (I-655)+(1.030)+(17.005), (I-655)+(1.030)+(17.006), (I-655)+(1.030)+(17.007), (I-655)+(1.030)+(17.008), (I-655)+(1.030)+(17.009), (I-655)+(1.030)+(17.010), (I-655)+(1.030)+(17.011), (I-655)+(1.030)+(17.012), (I-655)+(1.030)+(18.001),

(I-655)+(1.031)+(1.032), (I-655)+(1.031)+(1.033), (I-655)+(1.031)+(1.034), (I-655)+(1.031)+(1.035), (I-655)+(1.031)+(1.036), (I-655)+(1.031)+(1.037), (I-655)+(1.031)+(1.038), (I-655)+(1.031)+(1.039), (I-655)+(1.031)+(1.040), (I-655)+(1.031)+(1.041), (I-655)+(1.031)+(1.042), (I-655)+(1.031)+(1.043), (I-655)+(1.031)+(1.044), (I-655)+(1.031)+(1.045), (I-655)+(1.031)+(1.046), (I-655)+(1.031)+(1.047), (I-655)+(1.031)+(1.048), (I-655)+(1.031)+(1.049), (I-655)+(1.031)+(1.050), (I-655)+(1.031)+(1.051), (I-655)+(1.031)+(1.052), (I-655)+(1.031)+(1.053), (I-655)+(1.031)+(1.054), (I-655)+(1.031)+(1.055), (I-655)+(1.031)+(1.056), (I-655)+(1.031)+(1.057), (I-655)+(1.031)+(1.058), (I-655)+(1.031)+(1.059), (I-655)+(1.031)+(1.060), (I-655)+(1.031)+(1.061), (I-655)+(1.031)+(1.062), (I-655)+(1.031)+(1.063), (I-655)+(1.031)+(1.064), (I-655)+(1.031)+(1.065), (I-655)+(1.031)+(1.066), (I-655)+(1.031)+(1.067), (I-655)+(1.031)+(1.068), (I-655)+(1.031)+(1.069), (I-655)+(1.031)+(1.070), (I-655)+(1.031)+(1.071), (I-655)+(1.031)+(1.072), (I-655)+(1.031)+(1.073), (I-655)+(1.031)+(1.074), (I-655)+(1.031)+(1.075), (I-655)+(1.031)+(1.076), (I-655)+(1.031)+(1.077), (I-655)+(1.031)+(1.078), (I-655)+(1.031)+(1.079), (I-655)+(1.031)+(1.080), (I-655)+(1.031)+(1.081), (I-655)+(1.031)+(1.082), (I-655)+(1.031)+(1.083), (I-655)+(1.031)+(1.084), (I-655)+(1.031)+(1.085), (I-655)+(1.031)+(1.086), (I-655)+(1.031)+(1.087), (I-655)+(1.031)+(1.088), (I-655)+(1.031)+(1.089), (I-655)+(1.031)+(1.090), (I-655)+(1.031)+(1.091), (I-655)+(1.031)+(1.092), (I-655)+(1.031)+(2.001), (I-655)+(1.031)+(2.002), (I-655)+(1.031)+(2.003), (I-655)+(1.031)+(2.004), (I-655)+(1.031)+(2.005), (I-655)+(1.031)+(2.006), (I-655)+(1.031)+(2.007), (I-655)+(1.031)+(2.008), (I-655)+(1.031)+(2.009), (I-655)+(1.031)+(2.010), (I-655)+(1.031)+(2.011), (I-655)+(1.031)+(2.012), (I-655)+(1.031)+(2.013), (I-655)+(1.031)+(2.014), (I-655)+(1.031)+(2.015), (I-655)+(1.031)+(2.016), (I-655)+(1.031)+(2.017), (I-655)+(1.031)+(2.018), (I-655)+(1.031)+(2.019), (I-655)+(1.031)+(2.020), (I-655)+(1.031)+(2.021), (I-655)+(1.031)+(2.022), (I-655)+(1.031)+(2.023), (I-655)+(1.031)+(2.024), (I-655)+(1.031)+(2.025), (I-655)+(1.031)+(2.026), (I-655)+(1.031)+(2.027), (I-655)+(1.031)+(2.028), (I-655)+(1.031)+(2.029), (I-655)+(1.031)+(2.030), (I-655)+(1.031)+(2.031), (I-655)+(1.031)+(2.032), (I-655)+(1.031)+(2.033), (I-655)+(1.031)+(2.034), (I-655)+(1.031)+(2.035), (I-655)+(1.031)+(2.036), (I-655)+(1.031)+(2.037), (I-655)+(1.031)+(2.038), (I-655)+(1.031)+(2.039), (I-655)+(1.031)+(2.040), (I-655)+(1.031)+(2.041), (I-655)+(1.031)+(2.042), (I-655)+(1.031)+(2.043), (I-655)+(1.031)+(2.044), (I-655)+(1.031)+(2.045), (I-655)+(1.031)+(2.046), (I-655)+(1.031)+(2.047), (I-655)+(1.031)+(2.048), (I-655)+(1.031)+(2.049), (I-655)+(1.031)+(2.050), (I-655)+(1.031)+(2.051), (I-655)+(1.031)+(2.052), (I-655)+(1.031)+(2.053), (I-655)+(1.031)+(2.054), (I-655)+(1.031)+(2.055), (I-655)+(1.031)+(2.056), (I-655)+(1.031)+(2.057), (I-655)+(1.031)+(2.058), (I-655)+(1.031)+(2.059), (I-655)+(1.031)+(3.001), (I-655)+(1.031)+(3.002), (I-655)+(1.031)+(3.003), (I-655)+(1.031)+(3.004), (I-655)+(1.031)+(3.005), (I-655)+(1.031)+(3.006), (I-655)+(1.031)+(3.007), (I-655)+(1.031)+(3.008), (I-655)+(1.031)+(3.009), (I-655)+(1.031)+(3.010), (I-655)+(1.031)+(3.011), (I-655)+(1.031)+(3.012), (I-655)+(1.031)+(3.013), (I-655)+(1.031)+(3.014), (I-655)+(1.031)+(3.015), (I-655)+(1.031)+(3.016), (I-655)+(1.031)+(3.017), (I-655)+(1.031)+(3.018), (I-655)+(1.031)+(3.019), (I-655)+(1.031)+(3.020), (I-655)+(1.031)+(3.021), (I-655)+(1.031)+(3.022), (I-655)+(1.031)+(3.023), (I-655)+(1.031)+(3.024), (I-655)+(1.031)+(3.025), (I-655)+(1.031)+(3.026), (I-655)+(1.031)+(3.027), (I-655)+(1.031)+(3.028), (I-655)+(1.031)+(3.029), (I-655)+(1.031)+(3.030), (I-655)+(1.031)+(3.031), (I-655)+(1.031)+(5.001), (I-655)+(1.031)+(5.002), (I-655)+(1.031)+(5.003), (I-655)+(1.031)+(5.004), (I-655)+(1.031)+(5.005), (I-655)+(1.031)+(5.006), (I-655)+(1.031)+(5.007), (I-655)+(1.031)+(5.008), (I-655)+(1.031)+(5.009), (I-655)+(1.031)+(5.010), (I-655)+(1.031)+(5.011), (I-655)+(1.031)+(5.012), (I-655)+(1.031)+(5.013), (I-655)+(1.031)+(5.014), (I-655)+(1.031)+(5.015), (I-655)+(1.031)+(5.016), (I-655)+(1.031)+(5.017), (I-655)+(1.031)+(5.018), (I-655)+(1.031)+(5.019), (I-655)+(1.031)+(5.020), (I-655)+(1.031)+(5.021), (I-655)+(1.031)+(5.022), (I-655)+(1.031)+(5.023), (I-655)+(1.031)+(6.001), (I-655)+(1.031)+(6.002), (I-655)+(1.031)+(6.003), (I-655)+(1.031)+(6.004), (I-655)+(1.031)+(7.001), (I-655)+(1.031)+(7.002), (I-655)+(1.031)+(7.003), (I-655)+(1.031)+(7.004), (I-655)+(1.031)+(7.005), (I-655)+(1.031)+(7.006), (I-655)+(1.031)+(9.001), (I-655)+(1.031)+(9.002), (I-655)+(1.031)+(9.003), (I-655)+(1.031)+(9.004), (I-655)+(1.031)+(9.005), (I-655)+(1.031)+(9.006), (I-655)+(1.031)+(9.007), (I-655)+(1.031)+(9.008), (I-655)+(1.031)+(9.009), (I-655)+(1.031)+(14.001), (I-655)+(1.031)+(14.002), (I-655)+(1.031)+(15.008), (I-655)+(1.031)+(15.011), (I-655)+(1.031)+(15.012), (I-655)+(1.031)+(15.016), (I-655)+(1.031)+(15.025), (I-655)+(1.031)+(15.027), (I-655)+(1.031)+(15.047), (I-655)+(1.031)+(15.063), (I-655)+(1.031)+(15.064), (I-655)+(1.031)+(16.001), (I-655)+(1.031)+(16.002), (I-655)+(1.031)+(16.003), (I-655)+(1.031)+(16.004), (I-655)+(1.031)+(16.005), (I-655)+(1.031)+(16.006), (I-655)+(1.031)+(16.007), (I-655)+(1.031)+(16.008), (I-655)+(1.031)+(17.001), (I-655)+(1.031)+(17.002), (I-655)+(1.031)+(17.003), (I-655)+(1.031)+(17.004), (I-655)+(1.031)+(17.005), (I-655)+(1.031)+(17.006), (I-655)+(1.031)+(17.007), (I-655)+(1.031)+(17.008), (I-655)+(1.031)+(17.009), (I-655)+(1.031)+(17.010), (I-655)+(1.031)+(17.011), (I-655)+(1.031)+(17.012), (I-655)+(1.031)+(18.001),

(I-655)+(1.032)+(1.033), (I-655)+(1.032)+(1.034), (I-655)+(1.032)+(1.035), (I-655)+(1.032)+(1.036), (I-655)+(1.032)+(1.037), (I-655)+(1.032)+(1.038), (I-655)+(1.032)+(1.039), (I-655)+(1.032)+(1.040), (I-655)+(1.032)+(1.041), (I-655)+(1.032)+(1.042), (I-655)+(1.032)+(1.043), (I-655)+(1.032)+(1.044), (I-655)+(1.032)+(1.045), (I-655)+(1.032)+(1.046), (I-655)+(1.032)+(1.047), (I-655)+(1.032)+(1.048), (I-655)+(1.032)+(1.049), (I-655)+(1.032)+(1.050), (I-655)+(1.032)+(1.051), (I-655)+(1.032)+(1.052), (I-655)+(1.032)+(1.053), (I-655)+(1.032)+(1.054), (I-655)+(1.032)+(1.055), (I-655)+(1.032)+(1.056), (I-655)+(1.032)+(1.057), (I-655)+(1.032)+(1.058), (I-655)+(1.032)+(1.059), (I-655)+(1.032)+(1.060), (I-655)+(1.032)+(1.061), (I-655)+(1.032)+(1.062), (I-655)+(1.032)+(1.063), (I-655)+(1.032)+(1.064), (I-655)+(1.032)+(1.065), (I-655)+(1.032)+(1.066), (I-655)+(1.032)+(1.067), (I-655)+(1.032)+(1.068), (I-655)+(1.032)+(1.069), (I-655)+(1.032)+(1.070), (I-655)+(1.032)+(1.071), (I-655)+(1.032)+(1.072), (I-655)+(1.032)+(1.073), (I-655)+(1.032)+(1.074), (I-655)+(1.032)+(1.075), (I-655)+(1.032)+(1.076), (I-655)+(1.032)+(1.077), (I-655)+(1.032)+(1.078), (I-655)+(1.032)+(1.079), (I-655)+(1.032)+(1.080), (I-655)+(1.032)+(1.081), (I-655)+(1.032)+(1.082), (I-655)+(1.032)+(1.083), (I-655)+(1.032)+(1.084), (I-655)+(1.032)+(1.085), (I-655)+(1.032)+(1.086), (I-655)+(1.032)+(1.087), (I-655)+(1.032)+(1.088), (I-655)+(1.032)+(1.089), (I-655)+(1.032)+(1.090), (I-655)+(1.032)+(1.091), (I-655)+(1.032)+(1.092), (I-655)+(1.032)+(2.001), (I-655)+(1.032)+(2.002), (I-655)+(1.032)+(2.003), (I-655)+(1.032)+(2.004), (I-655)+(1.032)+(2.005), (I-655)+(1.032)+(2.006), (I-655)+(1.032)+(2.007), (I-655)+(1.032)+(2.008), (I-655)+(1.032)+(2.009), (I-655)+(1.032)+(2.010), (I-655)+(1.032)+(2.011), (I-655)+(1.032)+(2.012), (I-655)+(1.032)+(2.013), (I-655)+(1.032)+(2.014), (I-655)+(1.032)+(2.015), (I-655)+(1.032)+(2.016), (I-655)+(1.032)+(2.017), (I-655)+(1.032)+(2.018), (I-655)+(1.032)+(2.019), (I-655)+(1.032)+(2.020), (I-655)+(1.032)+(2.021), (I-655)+(1.032)+(2.022), (I-655)+(1.032)+(2.023), (I-655)+(1.032)+(2.024), (I-655)+(1.032)+(2.025), (I-655)+(1.032)+(2.026), (I-655)+(1.032)+(2.027), (I-655)+(1.032)+(2.028), (I-655)+(1.032)+(2.029), (I-655)+(1.032)+(2.030), (I-655)+(1.032)+(2.031), (I-655)+(1.032)+(2.032), (I-655)+(1.032)+(2.033), (I-655)+(1.032)+(2.034), (I-655)+(1.032)+(2.035), (I-655)+(1.032)+(2.036), (I-655)+(1.032)+(2.037), (I-655)+(1.032)+(2.038), (I-655)+(1.032)+(2.039), (I-655)+(1.032)+(2.040), (I-655)+(1.032)+(2.041), (I-655)+(1.032)+(2.042), (I-655)+(1.032)+(2.043), (I-655)+(1.032)+(2.044), (I-655)+(1.032)+(2.045), (I-655)+(1.032)+(2.046), (I-655)+(1.032)+(2.047), (I-655)+(1.032)+(2.048), (I-655)+(1.032)+(2.049), (I-655)+(1.032)+(2.050), (I-655)+(1.032)+(2.051), (I-655)+(1.032)+(2.052), (I-655)+(1.032)+(2.053), (I-655)+(1.032)+(2.054), (I-655)+(1.032)+(2.055), (I-655)+(1.032)+(2.056), (I-655)+(1.032)+(2.057), (I-655)+(1.032)+(2.058), (I-655)+(1.032)+(2.059), (I-655)+(1.032)+(3.001), (I-655)+(1.032)+(3.002), (I-655)+(1.032)+(3.003), (I-655)+(1.032)+(3.004), (I-655)+(1.032)+(3.005), (I-655)+(1.032)+(3.006), (I-655)+(1.032)+(3.007), (I-655)+(1.032)+(3.008), (I-655)+(1.032)+(3.009), (I-655)+(1.032)+(3.010), (I-655)+(1.032)+(3.011), (I-655)+(1.032)+(3.012), (I-655)+(1.032)+(3.013), (I-655)+(1.032)+(3.014), (I-655)+(1.032)+(3.015), (I-655)+(1.032)+(3.016), (I-655)+(1.032)+(3.017), (I-655)+(1.032)+(3.018), (I-655)+(1.032)+(3.019), (I-655)+(1.032)+(3.020), (I-655)+(1.032)+(3.021), (I-655)+(1.032)+(3.022), (I-655)+(1.032)+(3.023), (I-655)+(1.032)+(3.024), (I-655)+(1.032)+(3.025), (I-655)+(1.032)+(3.026), (I-655)+(1.032)+(3.027), (I-655)+(1.032)+(3.028), (I-655)+(1.032)+(3.029), (I-655)+(1.032)+(3.030), (I-655)+(1.032)+(3.031), (I-655)+(1.032)+(5.001), (I-655)+(1.032)+(5.002), (I-655)+(1.032)+(5.003), (I-655)+(1.032)+(5.004), (I-655)+(1.032)+(5.005), (I-655)+(1.032)+(5.006), (I-655)+(1.032)+(5.007), (I-655)+(1.032)+(5.008), (I-655)+(1.032)+(5.009), (I-655)+(1.032)+(5.010), (I-655)+(1.032)+(5.011), (I-655)+(1.032)+(5.012), (I-655)+(1.032)+(5.013), (I-655)+(1.032)+(5.014), (I-655)+(1.032)+(5.015), (I-655)+(1.032)+(5.016), (I-655)+(1.032)+(5.017), (I-655)+(1.032)+(5.018), (I-655)+(1.032)+(5.019), (I-655)+(1.032)+(5.020), (I-655)+(1.032)+(5.021), (I-655)+(1.032)+(5.022), (I-655)+(1.032)+(5.023), (I-655)+(1.032)+(6.001), (I-655)+(1.032)+(6.002), (I-655)+(1.032)+(6.003), (I-655)+(1.032)+(6.004), (I-655)+(1.032)+(7.001), (I-655)+(1.032)+(7.002), (I-655)+(1.032)+(7.003), (I-655)+(1.032)+(7.004), (I-655)+(1.032)+(7.005), (I-655)+(1.032)+(7.006), (I-655)+(1.032)+(9.001), (I-655)+(1.032)+(9.002), (I-655)+(1.032)+(9.003), (I-655)+(1.032)+(9.004), (I-655)+(1.032)+(9.005), (I-655)+(1.032)+(9.006), (I-655)+(1.032)+(9.007), (I-655)+(1.032)+(9.008), (I-655)+(1.032)+(9.009), (I-655)+(1.032)+(14.001), (I-655)+(1.032)+(14.002), (I-655)+(1.032)+(15.008), (I-655)+(1.032)+(15.011), (I-655)+(1.032)+(15.012), (I-655)+(1.032)+(15.016), (I-655)+(1.032)+(15.025), (I-655)+(1.032)+(15.027), (I-655)+(1.032)+(15.047), (I-655)+(1.032)+(15.063), (I-655)+(1.032)+(15.064), (I-655)+(1.032)+(16.001), (I-655)+(1.032)+(16.002), (I-655)+(1.032)+(16.003), (I-655)+(1.032)+(16.004), (I-655)+(1.032)+(16.005), (I-655)+(1.032)+(16.006), (I-655)+(1.032)+(16.007), (I-655)+(1.032)+(16.008), (I-655)+(1.032)+(17.001), (I-655)+(1.032)+(17.002), (I-655)+(1.032)+(17.003), (I-655)+(1.032)+(17.004), (I-655)+(1.032)+(17.005), (I-655)+(1.032)+(17.006), (I-655)+(1.032)+(17.007), (I-655)+(1.032)+(17.008), (I-655)+(1.032)+(17.009), (I-655)+(1.032)+(17.010), (I-655)+(1.032)+(17.011), (I-655)+(1.032)+(17.012), (I-655)+(1.032)+(18.001),

(I-655)+(1.033)+(1.034), (I-655)+(1.033)+(1.035), (I-655)+(1.033)+(1.036), (I-655)+(1.033)+(1.037), (I-655)+(1.033)+(1.038), (I-655)+(1.033)+(1.039), (I-655)+(1.033)+(1.040), (I-655)+(1.033)+(1.041), (I-655)+(1.033)+(1.042), (I-655)+(1.033)+(1.043), (I-655)+(1.033)+(1.044), (I-655)+(1.033)+(1.045), (I-655)+(1.033)+(1.046), (I-655)+(1.033)+(1.047), (I-655)+(1.033)+(1.048), (I-655)+(1.033)+(1.049), (I-655)+(1.033)+(1.050), (I-655)+(1.033)+(1.051), (I-655)+(1.033)+(1.052), (I-655)+(1.033)+(1.053), (I-655)+(1.033)+(1.054), (I-655)+(1.033)+(1.055), (I-655)+(1.033)+(1.056), (I-655)+(1.033)+(1.057), (I-655)+(1.033)+(1.058), (I-655)+(1.033)+(1.059), (I-655)+(1.033)+(1.060), (I-655)+(1.033)+(1.061), (I-655)+(1.033)+(1.062), (I-655)+(1.033)+(1.063), (I-655)+(1.033)+(1.064), (I-655)+(1.033)+(1.065), (I-655)+(1.033)+(1.066), (I-655)+(1.033)+(1.067), (I-655)+(1.033)+(1.068), (I-655)+(1.033)+(1.069), (I-655)+(1.033)+(1.070), (I-655)+(1.033)+(1.071), (I-655)+(1.033)+(1.072), (I-655)+(1.033)+(1.073), (I-655)+(1.033)+(1.074), (I-655)+(1.033)+(1.075), (I-655)+(1.033)+(1.076), (I-655)+(1.033)+(1.077), (I-655)+(1.033)+(1.078), (I-655)+(1.033)+(1.079), (I-655)+(1.033)+(1.080), (I-655)+(1.033)+(1.081), (I-655)+(1.033)+(1.082), (I-655)+(1.033)+(1.083), (I-655)+(1.033)+(1.084), (I-655)+(1.033)+(1.085), (I-655)+(1.033)+(1.086), (I-655)+(1.033)+(1.087), (I-655)+(1.033)+(1.088), (I-655)+(1.033)+(1.089), (I-655)+(1.033)+(1.090), (I-655)+(1.033)+(1.091), (I-655)+(1.033)+(1.092), (I-655)+(1.033)+(2.001), (I-655)+(1.033)+(2.002), (I-655)+(1.033)+(2.003), (I-655)+(1.033)+(2.004), (I-655)+(1.033)+(2.005), (I-655)+(1.033)+(2.006), (I-655)+(1.033)+(2.007), (I-655)+(1.033)+(2.008), (I-655)+(1.033)+(2.009), (I-655)+(1.033)+(2.010), (I-655)+(1.033)+(2.011), (I-655)+(1.033)+(2.012), (I-655)+(1.033)+(2.013), (I-655)+(1.033)+(2.014), (I-655)+(1.033)+(2.015), (I-655)+(1.033)+(2.016), (I-655)+(1.033)+(2.017), (I-655)+(1.033)+(2.018), (I-655)+(1.033)+(2.019), (I-655)+(1.033)+(2.020), (I-655)+(1.033)+(2.021), (I-655)+(1.033)+(2.022), (I-655)+(1.033)+(2.023), (I-655)+(1.033)+(2.024), (I-655)+(1.033)+(2.025), (I-655)+(1.033)+(2.026), (I-655)+(1.033)+(2.027), (I-655)+(1.033)+(2.028), (I-655)+(1.033)+(2.029), (I-655)+(1.033)+(2.030), (I-655)+(1.033)+(2.031), (I-655)+(1.033)+(2.032), (I-655)+(1.033)+(2.033), (I-655)+(1.033)+(2.034), (I-655)+(1.033)+(2.035), (I-655)+(1.033)+(2.036), (I-655)+(1.033)+(2.037), (I-655)+(1.033)+(2.038), (I-655)+(1.033)+(2.039), (I-655)+(1.033)+(2.040), (I-655)+(1.033)+(2.041), (I-655)+(1.033)+(2.042), (I-655)+(1.033)+(2.043), (I-655)+(1.033)+(2.044), (I-655)+(1.033)+(2.045), (I-655)+(1.033)+(2.046), (I-655)+(1.033)+(2.047), (I-655)+(1.033)+(2.048), (I-655)+(1.033)+(2.049), (I-655)+(1.033)+(2.050), (I-655)+(1.033)+(2.051), (I-655)+(1.033)+(2.052), (I-655)+(1.033)+(2.053), (I-655)+(1.033)+(2.054), (I-655)+(1.033)+(2.055), (I-655)+(1.033)+(2.056), (I-655)+(1.033)+(2.057), (I-655)+(1.033)+(2.058), (I-655)+(1.033)+(2.059), (I-655)+(1.033)+(3.001), (I-655)+(1.033)+(3.002), (I-655)+(1.033)+(3.003), (I-655)+(1.033)+(3.004), (I-655)+(1.033)+(3.005), (I-655)+(1.033)+(3.006), (I-655)+(1.033)+(3.007), (I-655)+(1.033)+(3.008), (I-655)+(1.033)+(3.009), (I-655)+(1.033)+(3.010), (I-655)+(1.033)+(3.011), (I-655)+(1.033)+(3.012), (I-655)+(1.033)+(3.013), (I-655)+(1.033)+(3.014), (I-655)+(1.033)+(3.015), (I-655)+(1.033)+(3.016), (I-655)+(1.033)+(3.017), (I-655)+(1.033)+(3.018), (I-655)+(1.033)+(3.019), (I-655)+(1.033)+(3.020), (I-655)+(1.033)+(3.021), (I-655)+(1.033)+(3.022), (I-655)+(1.033)+(3.023), (I-655)+(1.033)+(3.024), (I-655)+(1.033)+(3.025), (I-655)+(1.033)+(3.026), (I-655)+(1.033)+(3.027), (I-655)+(1.033)+(3.028), (I-655)+(1.033)+(3.029), (I-655)+(1.033)+(3.030), (I-655)+(1.033)+(3.031), (I-655)+(1.033)+(5.001), (I-655)+(1.033)+(5.002), (I-655)+(1.033)+(5.003), (I-655)+(1.033)+(5.004), (I-655)+(1.033)+(5.005), (I-655)+(1.033)+(5.006), (I-655)+(1.033)+(5.007), (I-655)+(1.033)+(5.008), (I-655)+(1.033)+(5.009), (I-655)+(1.033)+(5.010), (I-655)+(1.033)+(5.011), (I-655)+(1.033)+(5.012), (I-655)+(1.033)+(5.013), (I-655)+(1.033)+(5.014), (I-655)+(1.033)+(5.015), (I-655)+(1.033)+(5.016), (I-655)+(1.033)+(5.017), (I-655)+(1.033)+(5.018), (I-655)+(1.033)+(5.019), (I-655)+(1.033)+(5.020), (I-655)+(1.033)+(5.021), (I-655)+(1.033)+(5.022), (I-655)+(1.033)+(5.023), (I-655)+(1.033)+(6.001), (I-655)+(1.033)+(6.002), (I-655)+(1.033)+(6.003), (I-655)+(1.033)+(6.004), (I-655)+(1.033)+(7.001), (I-655)+(1.033)+(7.002), (I-655)+(1.033)+(7.003), (I-655)+(1.033)+(7.004), (I-655)+(1.033)+(7.005), (I-655)+(1.033)+(7.006), (I-655)+(1.033)+(9.001), (I-655)+(1.033)+(9.002), (I-655)+(1.033)+(9.003), (I-655)+(1.033)+(9.004), (I-655)+(1.033)+(9.005), (I-655)+(1.033)+(9.006), (I-655)+(1.033)+(9.007), (I-655)+(1.033)+(9.008), (I-655)+(1.033)+(9.009), (I-655)+(1.033)+(14.001), (I-655)+(1.033)+(14.002), (I-655)+(1.033)+(15.008), (I-655)+(1.033)+(15.011), (I-655)+(1.033)+(15.012), (I-655)+(1.033)+(15.016), (I-655)+(1.033)+(15.025), (I-655)+(1.033)+(15.027), (I-655)+(1.033)+(15.047), (I-655)+(1.033)+(15.063), (I-655)+(1.033)+(15.064), (I-655)+(1.033)+(16.001), (I-655)+(1.033)+(16.002), (I-655)+(1.033)+(16.003), (I-655)+(1.033)+(16.004), (I-655)+(1.033)+(16.005), (I-655)+(1.033)+(16.006), (I-655)+(1.033)+(16.007), (I-655)+(1.033)+(16.008), (I-655)+(1.033)+(17.001), (I-655)+(1.033)+(17.002), (I-655)+(1.033)+(17.003), (I-655)+(1.033)+(17.004), (I-655)+(1.033)+(17.005), (I-655)+(1.033)+(17.006), (I-655)+(1.033)+(17.007), (I-655)+(1.033)+(17.008), (I-655)+(1.033)+(17.009), (I-655)+(1.033)+(17.010), (I-655)+(1.033)+(17.011), (I-655)+(1.033)+(17.012), (I-655)+(1.033)+(18.001),

(I-655)+(1.034)+(1.035), (I-655)+(1.034)+(1.036), (I-655)+(1.034)+(1.037), (I-655)+(1.034)+(1.038), (I-655)+(1.034)+(1.039), (I-655)+(1.034)+(1.040), (I-655)+(1.034)+(1.041), (I-655)+(1.034)+(1.042), (I-655)+(1.034)+(1.043), (I-655)+(1.034)+(1.044), (I-655)+(1.034)+(1.045), (I-655)+(1.034)+(1.046), (I-655)+(1.034)+(1.047), (I-655)+(1.034)+(1.048), (I-655)+(1.034)+(1.049), (I-655)+(1.034)+(1.050), (I-655)+(1.034)+(1.051), (I-655)+(1.034)+(1.052), (I-655)+(1.034)+(1.053), (I-655)+(1.034)+(1.054), (I-655)+(1.034)+(1.055), (I-655)+(1.034)+(1.056), (I-655)+(1.034)+(1.057), (I-655)+(1.034)+(1.058), (I-655)+(1.034)+(1.059), (I-655)+(1.034)+(1.060), (I-655)+(1.034)+(1.061), (I-655)+(1.034)+(1.062), (I-655)+(1.034)+(1.063), (I-655)+(1.034)+(1.064), (I-655)+(1.034)+(1.065), (I-655)+(1.034)+(1.066), (I-655)+(1.034)+(1.067), (I-655)+(1.034)+(1.068), (I-655)+(1.034)+(1.069), (I-655)+(1.034)+(1.070), (I-655)+(1.034)+(1.071), (I-655)+(1.034)+(1.072), (I-655)+(1.034)+(1.073), (I-655)+(1.034)+(1.074), (I-655)+(1.034)+(1.075), (I-655)+(1.034)+(1.076), (I-655)+(1.034)+(1.077), (I-655)+(1.034)+(1.078), (I-655)+(1.034)+(1.079), (I-655)+(1.034)+(1.080), (I-655)+(1.034)+(1.081), (I-655)+(1.034)+(1.082), (I-655)+(1.034)+(1.083), (I-655)+(1.034)+(1.084), (I-655)+(1.034)+(1.085), (I-655)+(1.034)+(1.086), (I-655)+(1.034)+(1.087), (I-655)+(1.034)+(1.088), (I-655)+(1.034)+(1.089), (I-655)+(1.034)+(1.090), (I-655)+(1.034)+(1.091), (I-655)+(1.034)+(1.092), (I-655)+(1.034)+(2.001), (I-655)+(1.034)+(2.002), (I-655)+(1.034)+(2.003), (I-655)+(1.034)+(2.004), (I-655)+(1.034)+(2.005), (I-655)+(1.034)+(2.006), (I-655)+(1.034)+(2.007), (I-655)+(1.034)+(2.008), (I-655)+(1.034)+(2.009), (I-655)+(1.034)+(2.010), (I-655)+(1.034)+(2.011), (I-655)+(1.034)+(2.012), (I-655)+(1.034)+(2.013), (I-655)+(1.034)+(2.014), (I-655)+(1.034)+(2.015), (I-655)+(1.034)+(2.016), (I-655)+(1.034)+(2.017), (I-655)+(1.034)+(2.018), (I-655)+(1.034)+(2.019), (I-655)+(1.034)+(2.020), (I-655)+(1.034)+(2.021), (I-655)+(1.034)+(2.022), (I-655)+(1.034)+(2.023), (I-655)+(1.034)+(2.024), (I-655)+(1.034)+(2.025), (I-655)+(1.034)+(2.026), (I-655)+(1.034)+(2.027), (I-655)+(1.034)+(2.028), (I-655)+(1.034)+(2.029), (I-655)+(1.034)+(2.030), (I-655)+(1.034)+(2.031), (I-655)+(1.034)+(2.032), (I-655)+(1.034)+(2.033), (I-655)+(1.034)+(2.034), (I-655)+(1.034)+(2.035), (I-655)+(1.034)+(2.036), (I-655)+(1.034)+(2.037), (I-655)+(1.034)+(2.038), (I-655)+(1.034)+(2.039), (I-655)+(1.034)+(2.040), (I-655)+(1.034)+(2.041), (I-655)+(1.034)+(2.042), (I-655)+(1.034)+(2.043), (I-655)+(1.034)+(2.044), (I-655)+(1.034)+(2.045), (I-655)+(1.034)+(2.046), (I-655)+(1.034)+(2.047), (I-655)+(1.034)+(2.048), (I-655)+(1.034)+(2.049), (I-655)+(1.034)+(2.050), (I-655)+(1.034)+(2.051), (I-655)+(1.034)+(2.052), (I-655)+(1.034)+(2.053), (I-655)+(1.034)+(2.054), (I-655)+(1.034)+(2.055), (I-655)+(1.034)+(2.056), (I-655)+(1.034)+(2.057), (I-655)+(1.034)+(2.058), (I-655)+(1.034)+(2.059), (I-655)+(1.034)+(3.001), (I-655)+(1.034)+(3.002), (I-655)+(1.034)+(3.003), (I-655)+(1.034)+(3.004), (I-655)+(1.034)+(3.005), (I-655)+(1.034)+(3.006), (I-655)+(1.034)+(3.007), (I-655)+(1.034)+(3.008), (I-655)+(1.034)+(3.009), (I-655)+(1.034)+(3.010), (I-655)+(1.034)+(3.011), (I-655)+(1.034)+(3.012), (I-655)+(1.034)+(3.013), (I-655)+(1.034)+(3.014), (I-655)+(1.034)+(3.015), (I-655)+(1.034)+(3.016), (I-655)+(1.034)+(3.017), (I-655)+(1.034)+(3.018), (I-655)+(1.034)+(3.019), (I-655)+(1.034)+(3.020), (I-655)+(1.034)+(3.021), (I-655)+(1.034)+(3.022), (I-655)+(1.034)+(3.023), (I-655)+(1.034)+(3.024), (I-655)+(1.034)+(3.025), (I-655)+(1.034)+(3.026), (I-655)+(1.034)+(3.027), (I-655)+(1.034)+(3.028), (I-655)+(1.034)+(3.029), (I-655)+(1.034)+(3.030), (I-655)+(1.034)+(3.031), (I-655)+(1.034)+(5.001), (I-655)+(1.034)+(5.002), (I-655)+(1.034)+(5.003), (I-655)+(1.034)+(5.004), (I-655)+(1.034)+(5.005), (I-655)+(1.034)+(5.006), (I-655)+(1.034)+(5.007), (I-655)+(1.034)+(5.008), (I-655)+(1.034)+(5.009), (I-655)+(1.034)+(5.010), (I-655)+(1.034)+(5.011), (I-655)+(1.034)+(5.012), (I-655)+(1.034)+(5.013), (I-655)+(1.034)+(5.014), (I-655)+(1.034)+(5.015), (I-655)+(1.034)+(5.016), (I-655)+(1.034)+(5.017), (I-655)+(1.034)+(5.018), (I-655)+(1.034)+(5.019), (I-655)+(1.034)+(5.020), (I-655)+(1.034)+(5.021), (I-655)+(1.034)+(5.022), (I-655)+(1.034)+(5.023), (I-655)+(1.034)+(6.001), (I-655)+(1.034)+(6.002), (I-655)+(1.034)+(6.003), (I-655)+(1.034)+(6.004), (I-655)+(1.034)+(7.001), (I-655)+(1.034)+(7.002), (I-655)+(1.034)+(7.003), (I-655)+(1.034)+(7.004), (I-655)+(1.034)+(7.005), (I-655)+(1.034)+(7.006), (I-655)+(1.034)+(9.001), (I-655)+(1.034)+(9.002), (I-655)+(1.034)+(9.003), (I-655)+(1.034)+(9.004), (I-655)+(1.034)+(9.005), (I-655)+(1.034)+(9.006), (I-655)+(1.034)+(9.007), (I-655)+(1.034)+(9.008), (I-655)+(1.034)+(9.009), (I-655)+(1.034)+(14.001), (I-655)+(1.034)+(14.002), (I-655)+(1.034)+(15.008), (I-655)+(1.034)+(15.011), (I-655)+(1.034)+(15.012), (I-655)+(1.034)+(15.016), (I-655)+(1.034)+(15.025), (I-655)+(1.034)+(15.027), (I-655)+(1.034)+(15.047), (I-655)+(1.034)+(15.063), (I-655)+(1.034)+(15.064), (I-655)+(1.034)+(16.001), (I-655)+(1.034)+(16.002), (I-655)+(1.034)+(16.003), (I-655)+(1.034)+(16.004), (I-655)+(1.034)+(16.005), (I-655)+(1.034)+(16.006), (I-655)+(1.034)+(16.007), (I-655)+(1.034)+(16.008), (I-655)+(1.034)+(17.001), (I-655)+(1.034)+(17.002), (I-655)+(1.034)+(17.003), (I-655)+(1.034)+(17.004), (I-655)+(1.034)+(17.005), (I-655)+(1.034)+(17.006), (I-655)+(1.034)+(17.007), (I-655)+(1.034)+(17.008), (I-655)+(1.034)+(17.009), (I-655)+(1.034)+(17.010), (I-655)+(1.034)+(17.011), (I-655)+(1.034)+(17.012), (I-655)+(1.034)+(18.001),

(I-655)+(1.035)+(1.036), (I-655)+(1.035)+(1.037), (I-655)+(1.035)+(1.038), (I-655)+(1.035)+(1.039), (I-655)+(1.035)+(1.040), (I-655)+(1.035)+(1.041), (I-655)+(1.035)+(1.042), (I-655)+(1.035)+(1.043), (I-655)+(1.035)+(1.044), (I-655)+(1.035)+(1.045), (I-655)+(1.035)+(1.046), (I-655)+(1.035)+(1.047), (I-655)+(1.035)+(1.048), (I-655)+(1.035)+(1.049), (I-655)+(1.035)+(1.050), (I-655)+(1.035)+(1.051), (I-655)+(1.035)+(1.052), (I-655)+(1.035)+(1.053), (I-655)+(1.035)+(1.054), (I-655)+(1.035)+(1.055), (I-655)+(1.035)+(1.056), (I-655)+(1.035)+(1.057), (I-655)+(1.035)+(1.058), (I-655)+(1.035)+(1.059), (I-655)+(1.035)+(1.060), (I-655)+(1.035)+(1.061), (I-655)+(1.035)+(1.062), (I-655)+(1.035)+(1.063), (I-655)+(1.035)+(1.064), (I-655)+(1.035)+(1.065), (I-655)+(1.035)+(1.066), (I-655)+(1.035)+(1.067), (I-655)+(1.035)+(1.068), (I-655)+(1.035)+(1.069), (I-655)+(1.035)+(1.070), (I-655)+(1.035)+(1.071), (I-655)+(1.035)+(1.072), (I-655)+(1.035)+(1.073), (I-655)+(1.035)+(1.074), (I-655)+(1.035)+(1.075), (I-655)+(1.035)+(1.076), (I-655)+(1.035)+(1.077), (I-655)+(1.035)+(1.078), (I-655)+(1.035)+(1.079), (I-655)+(1.035)+(1.080), (I-655)+(1.035)+(1.081), (I-655)+(1.035)+(1.082), (I-655)+(1.035)+(1.083), (I-655)+(1.035)+(1.084), (I-655)+(1.035)+(1.085), (I-655)+(1.035)+(1.086), (I-655)+(1.035)+(1.087), (I-655)+(1.035)+(1.088), (I-655)+(1.035)+(1.089), (I-655)+(1.035)+(1.090), (I-655)+(1.035)+(1.091), (I-655)+(1.035)+(1.092), (I-655)+(1.035)+(2.001), (I-655)+(1.035)+(2.002), (I-655)+(1.035)+(2.003), (I-655)+(1.035)+(2.004), (I-655)+(1.035)+(2.005), (I-655)+(1.035)+(2.006), (I-655)+(1.035)+(2.007), (I-655)+(1.035)+(2.008), (I-655)+(1.035)+(2.009), (I-655)+(1.035)+(2.010), (I-655)+(1.035)+(2.011), (I-655)+(1.035)+(2.012), (I-655)+(1.035)+(2.013), (I-655)+(1.035)+(2.014), (I-655)+(1.035)+(2.015), (I-655)+(1.035)+(2.016), (I-655)+(1.035)+(2.017), (I-655)+(1.035)+(2.018), (I-655)+(1.035)+(2.019), (I-655)+(1.035)+(2.020), (I-655)+(1.035)+(2.021), (I-655)+(1.035)+(2.022), (I-655)+(1.035)+(2.023), (I-655)+(1.035)+(2.024), (I-655)+(1.035)+(2.025), (I-655)+(1.035)+(2.026), (I-655)+(1.035)+(2.027), (I-655)+(1.035)+(2.028), (I-655)+(1.035)+(2.029), (I-655)+(1.035)+(2.030), (I-655)+(1.035)+(2.031), (I-655)+(1.035)+(2.032), (I-655)+(1.035)+(2.033), (I-655)+(1.035)+(2.034), (I-655)+(1.035)+(2.035), (I-655)+(1.035)+(2.036), (I-655)+(1.035)+(2.037), (I-655)+(1.035)+(2.038), (I-655)+(1.035)+(2.039), (I-655)+(1.035)+(2.040), (I-655)+(1.035)+(2.041), (I-655)+(1.035)+(2.042), (I-655)+(1.035)+(2.043), (I-655)+(1.035)+(2.044), (I-655)+(1.035)+(2.045), (I-655)+(1.035)+(2.046), (I-655)+(1.035)+(2.047), (I-655)+(1.035)+(2.048), (I-655)+(1.035)+(2.049), (I-655)+(1.035)+(2.050), (I-655)+(1.035)+(2.051), (I-655)+(1.035)+(2.052), (I-655)+(1.035)+(2.053), (I-655)+(1.035)+(2.054), (I-655)+(1.035)+(2.055), (I-655)+(1.035)+(2.056), (I-655)+(1.035)+(2.057), (I-655)+(1.035)+(2.058), (I-655)+(1.035)+(2.059), (I-655)+(1.035)+(3.001), (I-655)+(1.035)+(3.002), (I-655)+(1.035)+(3.003), (I-655)+(1.035)+(3.004), (I-655)+(1.035)+(3.005), (I-655)+(1.035)+(3.006), (I-655)+(1.035)+(3.007), (I-655)+(1.035)+(3.008), (I-655)+(1.035)+(3.009), (I-655)+(1.035)+(3.010), (I-655)+(1.035)+(3.011), (I-655)+(1.035)+(3.012), (I-655)+(1.035)+(3.013), (I-655)+(1.035)+(3.014), (I-655)+(1.035)+(3.015), (I-655)+(1.035)+(3.016), (I-655)+(1.035)+(3.017), (I-655)+(1.035)+(3.018), (I-655)+(1.035)+(3.019), (I-655)+(1.035)+(3.020), (I-655)+(1.035)+(3.021), (I-655)+(1.035)+(3.022), (I-655)+(1.035)+(3.023), (I-655)+(1.035)+(3.024), (I-655)+(1.035)+(3.025), (I-655)+(1.035)+(3.026), (I-655)+(1.035)+(3.027), (I-655)+(1.035)+(3.028), (I-655)+(1.035)+(3.029), (I-655)+(1.035)+(3.030), (I-655)+(1.035)+(3.031), (I-655)+(1.035)+(5.001), (I-655)+(1.035)+(5.002), (I-655)+(1.035)+(5.003), (I-655)+(1.035)+(5.004), (I-655)+(1.035)+(5.005), (I-655)+(1.035)+(5.006), (I-655)+(1.035)+(5.007), (I-655)+(1.035)+(5.008), (I-655)+(1.035)+(5.009), (I-655)+(1.035)+(5.010), (I-655)+(1.035)+(5.011), (I-655)+(1.035)+(5.012), (I-655)+(1.035)+(5.013), (I-655)+(1.035)+(5.014), (I-655)+(1.035)+(5.015), (I-655)+(1.035)+(5.016), (I-655)+(1.035)+(5.017), (I-655)+(1.035)+(5.018), (I-655)+(1.035)+(5.019), (I-655)+(1.035)+(5.020), (I-655)+(1.035)+(5.021), (I-655)+(1.035)+(5.022), (I-655)+(1.035)+(5.023), (I-655)+(1.035)+(6.001), (I-655)+(1.035)+(6.002), (I-655)+(1.035)+(6.003), (I-655)+(1.035)+(6.004), (I-655)+(1.035)+(7.001), (I-655)+(1.035)+(7.002), (I-655)+(1.035)+(7.003), (I-655)+(1.035)+(7.004), (I-655)+(1.035)+(7.005), (I-655)+(1.035)+(7.006), (I-655)+(1.035)+(9.001), (I-655)+(1.035)+(9.002), (I-655)+(1.035)+(9.003), (I-655)+(1.035)+(9.004), (I-655)+(1.035)+(9.005), (I-655)+(1.035)+(9.006), (I-655)+(1.035)+(9.007), (I-655)+(1.035)+(9.008), (I-655)+(1.035)+(9.009), (I-655)+(1.035)+(14.001), (I-655)+(1.035)+(14.002), (I-655)+(1.035)+(15.008), (I-655)+(1.035)+(15.011), (I-655)+(1.035)+(15.012), (I-655)+(1.035)+(15.016), (I-655)+(1.035)+(15.025), (I-655)+(1.035)+(15.027), (I-655)+(1.035)+(15.047), (I-655)+(1.035)+(15.063), (I-655)+(1.035)+(15.064), (I-655)+(1.035)+(16.001), (I-655)+(1.035)+(16.002), (I-655)+(1.035)+(16.003), (I-655)+(1.035)+(16.004), (I-655)+(1.035)+(16.005), (I-655)+(1.035)+(16.006), (I-655)+(1.035)+(16.007), (I-655)+(1.035)+(16.008), (I-655)+(1.035)+(17.001), (I-655)+(1.035)+(17.002), (I-655)+(1.035)+(17.003), (I-655)+(1.035)+(17.004), (I-655)+(1.035)+(17.005), (I-655)+(1.035)+(17.006), (I-655)+(1.035)+(17.007), (I-655)+(1.035)+(17.008), (I-655)+(1.035)+(17.009), (I-655)+(1.035)+(17.010), (I-655)+(1.035)+(17.011), (I-655)+(1.035)+(17.012), (I-655)+(1.035)+(18.001),

(I-655)+(1.036)+(1.037), (I-655)+(1.036)+(1.038), (I-655)+(1.036)+(1.039), (I-655)+(1.036)+(1.040), (I-655)+(1.036)+(1.041), (I-655)+(1.036)+(1.042), (I-655)+(1.036)+(1.043), (I-655)+(1.036)+(1.044), (I-655)+(1.036)+(1.045), (I-655)+(1.036)+(1.046), (I-655)+(1.036)+(1.047), (I-655)+(1.036)+(1.048), (I-655)+(1.036)+(1.049), (I-655)+(1.036)+(1.050), (I-655)+(1.036)+(1.051), (I-655)+(1.036)+(1.052), (I-655)+(1.036)+(1.053), (I-655)+(1.036)+(1.054), (I-655)+(1.036)+(1.055), (I-655)+(1.036)+(1.056), (I-655)+(1.036)+(1.057), (I-655)+(1.036)+(1.058), (I-655)+(1.036)+(1.059), (I-655)+(1.036)+(1.060), (I-655)+(1.036)+(1.061), (I-655)+(1.036)+(1.062), (I-655)+(1.036)+(1.063), (I-655)+(1.036)+(1.064), (I-655)+(1.036)+(1.065), (I-655)+(1.036)+(1.066), (I-655)+(1.036)+(1.067), (I-655)+(1.036)+(1.068), (I-655)+(1.036)+(1.069), (I-655)+(1.036)+(1.070), (I-655)+(1.036)+(1.071), (I-655)+(1.036)+(1.072), (I-655)+(1.036)+(1.073), (I-655)+(1.036)+(1.074), (I-655)+(1.036)+(1.075), (I-655)+(1.036)+(1.076), (I-655)+(1.036)+(1.077), (I-655)+(1.036)+(1.078), (I-655)+(1.036)+(1.079), (I-655)+(1.036)+(1.080), (I-655)+(1.036)+(1.081), (I-655)+(1.036)+(1.082), (I-655)+(1.036)+(1.083), (I-655)+(1.036)+(1.084), (I-655)+(1.036)+(1.085), (I-655)+(1.036)+(1.086), (I-655)+(1.036)+(1.087), (I-655)+(1.036)+(1.088), (I-655)+(1.036)+(1.089), (I-655)+(1.036)+(1.090), (I-655)+(1.036)+(1.091), (I-655)+(1.036)+(1.092), (I-655)+(1.036)+(2.001), (I-655)+(1.036)+(2.002), (I-655)+(1.036)+(2.003), (I-655)+(1.036)+(2.004), (I-655)+(1.036)+(2.005), (I-655)+(1.036)+(2.006), (I-655)+(1.036)+(2.007), (I-655)+(1.036)+(2.008), (I-655)+(1.036)+(2.009), (I-655)+(1.036)+(2.010), (I-655)+(1.036)+(2.011), (I-655)+(1.036)+(2.012), (I-655)+(1.036)+(2.013), (I-655)+(1.036)+(2.014), (I-655)+(1.036)+(2.015), (I-655)+(1.036)+(2.016), (I-655)+(1.036)+(2.017), (I-655)+(1.036)+(2.018), (I-655)+(1.036)+(2.019), (I-655)+(1.036)+(2.020), (I-655)+(1.036)+(2.021), (I-655)+(1.036)+(2.022), (I-655)+(1.036)+(2.023), (I-655)+(1.036)+(2.024), (I-655)+(1.036)+(2.025), (I-655)+(1.036)+(2.026), (I-655)+(1.036)+(2.027), (I-655)+(1.036)+(2.028), (I-655)+(1.036)+(2.029), (I-655)+(1.036)+(2.030), (I-655)+(1.036)+(2.031), (I-655)+(1.036)+(2.032), (I-655)+(1.036)+(2.033), (I-655)+(1.036)+(2.034), (I-655)+(1.036)+(2.035), (I-655)+(1.036)+(2.036), (I-655)+(1.036)+(2.037), (I-655)+(1.036)+(2.038), (I-655)+(1.036)+(2.039), (I-655)+(1.036)+(2.040), (I-655)+(1.036)+(2.041), (I-655)+(1.036)+(2.042), (I-655)+(1.036)+(2.043), (I-655)+(1.036)+(2.044), (I-655)+(1.036)+(2.045), (I-655)+(1.036)+(2.046), (I-655)+(1.036)+(2.047), (I-655)+(1.036)+(2.048), (I-655)+(1.036)+(2.049), (I-655)+(1.036)+(2.050), (I-655)+(1.036)+(2.051), (I-655)+(1.036)+(2.052), (I-655)+(1.036)+(2.053), (I-655)+(1.036)+(2.054), (I-655)+(1.036)+(2.055), (I-655)+(1.036)+(2.056), (I-655)+(1.036)+(2.057), (I-655)+(1.036)+(2.058), (I-655)+(1.036)+(2.059), (I-655)+(1.036)+(3.001), (I-655)+(1.036)+(3.002), (I-655)+(1.036)+(3.003), (I-655)+(1.036)+(3.004), (I-655)+(1.036)+(3.005), (I-655)+(1.036)+(3.006), (I-655)+(1.036)+(3.007), (I-655)+(1.036)+(3.008), (I-655)+(1.036)+(3.009), (I-655)+(1.036)+(3.010), (I-655)+(1.036)+(3.011), (I-655)+(1.036)+(3.012), (I-655)+(1.036)+(3.013), (I-655)+(1.036)+(3.014), (I-655)+(1.036)+(3.015), (I-655)+(1.036)+(3.016), (I-655)+(1.036)+(3.017), (I-655)+(1.036)+(3.018), (I-655)+(1.036)+(3.019), (I-655)+(1.036)+(3.020), (I-655)+(1.036)+(3.021), (I-655)+(1.036)+(3.022), (I-655)+(1.036)+(3.023), (I-655)+(1.036)+(3.024), (I-655)+(1.036)+(3.025), (I-655)+(1.036)+(3.026), (I-655)+(1.036)+(3.027), (I-655)+(1.036)+(3.028), (I-655)+(1.036)+(3.029), (I-655)+(1.036)+(3.030), (I-655)+(1.036)+(3.031), (I-655)+(1.036)+(5.001), (I-655)+(1.036)+(5.002), (I-655)+(1.036)+(5.003), (I-655)+(1.036)+(5.004), (I-655)+(1.036)+(5.005), (I-655)+(1.036)+(5.006), (I-655)+(1.036)+(5.007), (I-655)+(1.036)+(5.008), (I-655)+(1.036)+(5.009), (I-655)+(1.036)+(5.010), (I-655)+(1.036)+(5.011), (I-655)+(1.036)+(5.012), (I-655)+(1.036)+(5.013), (I-655)+(1.036)+(5.014), (I-655)+(1.036)+(5.015), (I-655)+(1.036)+(5.016), (I-655)+(1.036)+(5.017), (I-655)+(1.036)+(5.018), (I-655)+(1.036)+(5.019), (I-655)+(1.036)+(5.020), (I-655)+(1.036)+(5.021), (I-655)+(1.036)+(5.022), (I-655)+(1.036)+(5.023), (I-655)+(1.036)+(6.001), (I-655)+(1.036)+(6.002), (I-655)+(1.036)+(6.003), (I-655)+(1.036)+(6.004), (I-655)+(1.036)+(7.001), (I-655)+(1.036)+(7.002), (I-655)+(1.036)+(7.003), (I-655)+(1.036)+(7.004), (I-655)+(1.036)+(7.005), (I-655)+(1.036)+(7.006), (I-655)+(1.036)+(9.001), (I-655)+(1.036)+(9.002), (I-655)+(1.036)+(9.003), (I-655)+(1.036)+(9.004), (I-655)+(1.036)+(9.005), (I-655)+(1.036)+(9.006), (I-655)+(1.036)+(9.007), (I-655)+(1.036)+(9.008), (I-655)+(1.036)+(9.009), (I-655)+(1.036)+(14.001), (I-655)+(1.036)+(14.002), (I-655)+(1.036)+(15.008), (I-655)+(1.036)+(15.011), (I-655)+(1.036)+(15.012), (I-655)+(1.036)+(15.016), (I-655)+(1.036)+(15.025), (I-655)+(1.036)+(15.027), (I-655)+(1.036)+(15.047), (I-655)+(1.036)+(15.063), (I-655)+(1.036)+(15.064), (I-655)+(1.036)+(16.001), (I-655)+(1.036)+(16.002), (I-655)+(1.036)+(16.003), (I-655)+(1.036)+(16.004), (I-655)+(1.036)+(16.005), (I-655)+(1.036)+(16.006), (I-655)+(1.036)+(16.007), (I-655)+(1.036)+(16.008), (I-655)+(1.036)+(17.001), (I-655)+(1.036)+(17.002), (I-655)+(1.036)+(17.003), (I-655)+(1.036)+(17.004), (I-655)+(1.036)+(17.005), (I-655)+(1.036)+(17.006), (I-655)+(1.036)+(17.007), (I-655)+(1.036)+(17.008), (I-655)+(1.036)+(17.009), (I-655)+(1.036)+(17.010), (I-655)+(1.036)+(17.011), (I-655)+(1.036)+(17.012), (I-655)+(1.036)+(18.001),

(I-655)+(1.037)+(1.038), (I-655)+(1.037)+(1.039), (I-655)+(1.037)+(1.040), (I-655)+(1.037)+(1.041), (I-655)+(1.037)+(1.042), (I-655)+(1.037)+(1.043), (I-655)+(1.037)+(1.044), (I-655)+(1.037)+(1.045), (I-655)+(1.037)+(1.046), (I-655)+(1.037)+(1.047), (I-655)+(1.037)+(1.048), (I-655)+(1.037)+(1.049), (I-655)+(1.037)+(1.050), (I-655)+(1.037)+(1.051), (I-655)+(1.037)+(1.052), (I-655)+(1.037)+(1.053), (I-655)+(1.037)+(1.054), (I-655)+(1.037)+(1.055), (I-655)+(1.037)+(1.056), (I-655)+(1.037)+(1.057), (I-655)+(1.037)+(1.058), (I-655)+(1.037)+(1.059), (I-655)+(1.037)+(1.060), (I-655)+(1.037)+(1.061), (I-655)+(1.037)+(1.062), (I-655)+(1.037)+(1.063), (I-655)+(1.037)+(1.064), (I-655)+(1.037)+(1.065), (I-655)+(1.037)+(1.066), (I-655)+(1.037)+(1.067), (I-655)+(1.037)+(1.068), (I-655)+(1.037)+(1.069), (I-655)+(1.037)+(1.070), (I-655)+(1.037)+(1.071), (I-655)+(1.037)+(1.072), (I-655)+(1.037)+(1.073), (I-655)+(1.037)+(1.074), (I-655)+(1.037)+(1.075), (I-655)+(1.037)+(1.076), (I-655)+(1.037)+(1.077), (I-655)+(1.037)+(1.078), (I-655)+(1.037)+(1.079), (I-655)+(1.037)+(1.080), (I-655)+(1.037)+(1.081), (I-655)+(1.037)+(1.082), (I-655)+(1.037)+(1.083), (I-655)+(1.037)+(1.084), (I-655)+(1.037)+(1.085), (I-655)+(1.037)+(1.086), (I-655)+(1.037)+(1.087), (I-655)+(1.037)+(1.088), (I-655)+(1.037)+(1.089), (I-655)+(1.037)+(1.090), (I-655)+(1.037)+(1.091), (I-655)+(1.037)+(1.092), (I-655)+(1.037)+(2.001), (I-655)+(1.037)+(2.002), (I-655)+(1.037)+(2.003), (I-655)+(1.037)+(2.004), (I-655)+(1.037)+(2.005), (I-655)+(1.037)+(2.006), (I-655)+(1.037)+(2.007), (I-655)+(1.037)+(2.008), (I-655)+(1.037)+(2.009), (I-655)+(1.037)+(2.010), (I-655)+(1.037)+(2.011), (I-655)+(1.037)+(2.012), (I-655)+(1.037)+(2.013), (I-655)+(1.037)+(2.014), (I-655)+(1.037)+(2.015), (I-655)+(1.037)+(2.016), (I-655)+(1.037)+(2.017), (I-655)+(1.037)+(2.018), (I-655)+(1.037)+(2.019), (I-655)+(1.037)+(2.020), (I-655)+(1.037)+(2.021), (I-655)+(1.037)+(2.022), (I-655)+(1.037)+(2.023), (I-655)+(1.037)+(2.024), (I-655)+(1.037)+(2.025), (I-655)+(1.037)+(2.026), (I-655)+(1.037)+(2.027), (I-655)+(1.037)+(2.028), (I-655)+(1.037)+(2.029), (I-655)+(1.037)+(2.030), (I-655)+(1.037)+(2.031), (I-655)+(1.037)+(2.032), (I-655)+(1.037)+(2.033), (I-655)+(1.037)+(2.034), (I-655)+(1.037)+(2.035), (I-655)+(1.037)+(2.036), (I-655)+(1.037)+(2.037), (I-655)+(1.037)+(2.038), (I-655)+(1.037)+(2.039), (I-655)+(1.037)+(2.040), (I-655)+(1.037)+(2.041), (I-655)+(1.037)+(2.042), (I-655)+(1.037)+(2.043), (I-655)+(1.037)+(2.044), (I-655)+(1.037)+(2.045), (I-655)+(1.037)+(2.046), (I-655)+(1.037)+(2.047), (I-655)+(1.037)+(2.048), (I-655)+(1.037)+(2.049), (I-655)+(1.037)+(2.050), (I-655)+(1.037)+(2.051), (I-655)+(1.037)+(2.052), (I-655)+(1.037)+(2.053), (I-655)+(1.037)+(2.054), (I-655)+(1.037)+(2.055), (I-655)+(1.037)+(2.056), (I-655)+(1.037)+(2.057), (I-655)+(1.037)+(2.058), (I-655)+(1.037)+(2.059), (I-655)+(1.037)+(3.001), (I-655)+(1.037)+(3.002), (I-655)+(1.037)+(3.003), (I-655)+(1.037)+(3.004), (I-655)+(1.037)+(3.005), (I-655)+(1.037)+(3.006), (I-655)+(1.037)+(3.007), (I-655)+(1.037)+(3.008), (I-655)+(1.037)+(3.009), (I-655)+(1.037)+(3.010), (I-655)+(1.037)+(3.011), (I-655)+(1.037)+(3.012), (I-655)+(1.037)+(3.013), (I-655)+(1.037)+(3.014), (I-655)+(1.037)+(3.015), (I-655)+(1.037)+(3.016), (I-655)+(1.037)+(3.017), (I-655)+(1.037)+(3.018), (I-655)+(1.037)+(3.019), (I-655)+(1.037)+(3.020), (I-655)+(1.037)+(3.021), (I-655)+(1.037)+(3.022), (I-655)+(1.037)+(3.023), (I-655)+(1.037)+(3.024), (I-655)+(1.037)+(3.025), (I-655)+(1.037)+(3.026), (I-655)+(1.037)+(3.027), (I-655)+(1.037)+(3.028), (I-655)+(1.037)+(3.029), (I-655)+(1.037)+(3.030), (I-655)+(1.037)+(3.031), (I-655)+(1.037)+(5.001), (I-655)+(1.037)+(5.002), (I-655)+(1.037)+(5.003), (I-655)+(1.037)+(5.004), (I-655)+(1.037)+(5.005), (I-655)+(1.037)+(5.006), (I-655)+(1.037)+(5.007), (I-655)+(1.037)+(5.008), (I-655)+(1.037)+(5.009), (I-655)+(1.037)+(5.010), (I-655)+(1.037)+(5.011), (I-655)+(1.037)+(5.012), (I-655)+(1.037)+(5.013), (I-655)+(1.037)+(5.014), (I-655)+(1.037)+(5.015), (I-655)+(1.037)+(5.016), (I-655)+(1.037)+(5.017), (I-655)+(1.037)+(5.018), (I-655)+(1.037)+(5.019), (I-655)+(1.037)+(5.020), (I-655)+(1.037)+(5.021), (I-655)+(1.037)+(5.022), (I-655)+(1.037)+(5.023), (I-655)+(1.037)+(6.001), (I-655)+(1.037)+(6.002), (I-655)+(1.037)+(6.003), (I-655)+(1.037)+(6.004), (I-655)+(1.037)+(7.001), (I-655)+(1.037)+(7.002), (I-655)+(1.037)+(7.003), (I-655)+(1.037)+(7.004), (I-655)+(1.037)+(7.005), (I-655)+(1.037)+(7.006), (I-655)+(1.037)+(9.001), (I-655)+(1.037)+(9.002), (I-655)+(1.037)+(9.003), (I-655)+(1.037)+(9.004), (I-655)+(1.037)+(9.005), (I-655)+(1.037)+(9.006), (I-655)+(1.037)+(9.007), (I-655)+(1.037)+(9.008), (I-655)+(1.037)+(9.009), (I-655)+(1.037)+(14.001), (I-655)+(1.037)+(14.002), (I-655)+(1.037)+(15.008), (I-655)+(1.037)+(15.011), (I-655)+(1.037)+(15.012), (I-655)+(1.037)+(15.016), (I-655)+(1.037)+(15.025), (I-655)+(1.037)+(15.027), (I-655)+(1.037)+(15.047), (I-655)+(1.037)+(15.063), (I-655)+(1.037)+(15.064), (I-655)+(1.037)+(16.001), (I-655)+(1.037)+(16.002), (I-655)+(1.037)+(16.003), (I-655)+(1.037)+(16.004), (I-655)+(1.037)+(16.005), (I-655)+(1.037)+(16.006), (I-655)+(1.037)+(16.007), (I-655)+(1.037)+(16.008), (I-655)+(1.037)+(17.001), (I-655)+(1.037)+(17.002), (I-655)+(1.037)+(17.003), (I-655)+(1.037)+(17.004), (I-655)+(1.037)+(17.005), (I-655)+(1.037)+(17.006), (I-655)+(1.037)+(17.007), (I-655)+(1.037)+(17.008), (I-655)+(1.037)+(17.009), (I-655)+(1.037)+(17.010), (I-655)+(1.037)+(17.011), (I-655)+(1.037)+(17.012), (I-655)+(1.037)+(18.001),

(I-655)+(1.038)+(1.039), (I-655)+(1.038)+(1.040), (I-655)+(1.038)+(1.041), (I-655)+(1.038)+(1.042), (I-655)+(1.038)+(1.043), (I-655)+(1.038)+(1.044), (I-655)+(1.038)+(1.045), (I-655)+(1.038)+(1.046), (I-655)+(1.038)+(1.047), (I-655)+(1.038)+(1.048), (I-655)+(1.038)+(1.049), (I-655)+(1.038)+(1.050), (I-655)+(1.038)+(1.051), (I-655)+(1.038)+(1.052), (I-655)+(1.038)+(1.053), (I-655)+(1.038)+(1.054), (I-655)+(1.038)+(1.055), (I-655)+(1.038)+(1.056), (I-655)+(1.038)+(1.057), (I-655)+(1.038)+(1.058), (I-655)+(1.038)+(1.059), (I-655)+(1.038)+(1.060), (I-655)+(1.038)+(1.061), (I-655)+(1.038)+(1.062), (I-655)+(1.038)+(1.063), (I-655)+(1.038)+(1.064), (I-655)+(1.038)+(1.065), (I-655)+(1.038)+(1.066), (I-655)+(1.038)+(1.067), (I-655)+(1.038)+(1.068), (I-655)+(1.038)+(1.069), (I-655)+(1.038)+(1.070), (I-655)+(1.038)+(1.071), (I-655)+(1.038)+(1.072), (I-655)+(1.038)+(1.073), (I-655)+(1.038)+(1.074), (I-655)+(1.038)+(1.075), (I-655)+(1.038)+(1.076), (I-655)+(1.038)+(1.077), (I-655)+(1.038)+(1.078), (I-655)+(1.038)+(1.079), (I-655)+(1.038)+(1.080), (I-655)+(1.038)+(1.081), (I-655)+(1.038)+(1.082), (I-655)+(1.038)+(1.083), (I-655)+(1.038)+(1.084), (I-655)+(1.038)+(1.085), (I-655)+(1.038)+(1.086), (I-655)+(1.038)+(1.087), (I-655)+(1.038)+(1.088), (I-655)+(1.038)+(1.089), (I-655)+(1.038)+(1.090), (I-655)+(1.038)+(1.091), (I-655)+(1.038)+(1.092), (I-655)+(1.038)+(2.001), (I-655)+(1.038)+(2.002), (I-655)+(1.038)+(2.003), (I-655)+(1.038)+(2.004), (I-655)+(1.038)+(2.005), (I-655)+(1.038)+(2.006), (I-655)+(1.038)+(2.007), (I-655)+(1.038)+(2.008), (I-655)+(1.038)+(2.009), (I-655)+(1.038)+(2.010), (I-655)+(1.038)+(2.011), (I-655)+(1.038)+(2.012), (I-655)+(1.038)+(2.013), (I-655)+(1.038)+(2.014), (I-655)+(1.038)+(2.015), (I-655)+(1.038)+(2.016), (I-655)+(1.038)+(2.017), (I-655)+(1.038)+(2.018), (I-655)+(1.038)+(2.019), (I-655)+(1.038)+(2.020), (I-655)+(1.038)+(2.021), (I-655)+(1.038)+(2.022), (I-655)+(1.038)+(2.023), (I-655)+(1.038)+(2.024), (I-655)+(1.038)+(2.025), (I-655)+(1.038)+(2.026), (I-655)+(1.038)+(2.027), (I-655)+(1.038)+(2.028), (I-655)+(1.038)+(2.029), (I-655)+(1.038)+(2.030), (I-655)+(1.038)+(2.031), (I-655)+(1.038)+(2.032), (I-655)+(1.038)+(2.033), (I-655)+(1.038)+(2.034), (I-655)+(1.038)+(2.035), (I-655)+(1.038)+(2.036), (I-655)+(1.038)+(2.037), (I-655)+(1.038)+(2.038), (I-655)+(1.038)+(2.039), (I-655)+(1.038)+(2.040), (I-655)+(1.038)+(2.041), (I-655)+(1.038)+(2.042), (I-655)+(1.038)+(2.043), (I-655)+(1.038)+(2.044), (I-655)+(1.038)+(2.045), (I-655)+(1.038)+(2.046), (I-655)+(1.038)+(2.047), (I-655)+(1.038)+(2.048), (I-655)+(1.038)+(2.049), (I-655)+(1.038)+(2.050), (I-655)+(1.038)+(2.051), (I-655)+(1.038)+(2.052), (I-655)+(1.038)+(2.053), (I-655)+(1.038)+(2.054), (I-655)+(1.038)+(2.055), (I-655)+(1.038)+(2.056), (I-655)+(1.038)+(2.057), (I-655)+(1.038)+(2.058), (I-655)+(1.038)+(2.059), (I-655)+(1.038)+(3.001), (I-655)+(1.038)+(3.002), (I-655)+(1.038)+(3.003), (I-655)+(1.038)+(3.004), (I-655)+(1.038)+(3.005), (I-655)+(1.038)+(3.006), (I-655)+(1.038)+(3.007), (I-655)+(1.038)+(3.008), (I-655)+(1.038)+(3.009), (I-655)+(1.038)+(3.010), (I-655)+(1.038)+(3.011), (I-655)+(1.038)+(3.012), (I-655)+(1.038)+(3.013), (I-655)+(1.038)+(3.014), (I-655)+(1.038)+(3.015), (I-655)+(1.038)+(3.016), (I-655)+(1.038)+(3.017), (I-655)+(1.038)+(3.018), (I-655)+(1.038)+(3.019), (I-655)+(1.038)+(3.020), (I-655)+(1.038)+(3.021), (I-655)+(1.038)+(3.022), (I-655)+(1.038)+(3.023), (I-655)+(1.038)+(3.024), (I-655)+(1.038)+(3.025), (I-655)+(1.038)+(3.026), (I-655)+(1.038)+(3.027), (I-655)+(1.038)+(3.028), (I-655)+(1.038)+(3.029), (I-655)+(1.038)+(3.030), (I-655)+(1.038)+(3.031), (I-655)+(1.038)+(5.001), (I-655)+(1.038)+(5.002), (I-655)+(1.038)+(5.003), (I-655)+(1.038)+(5.004), (I-655)+(1.038)+(5.005), (I-655)+(1.038)+(5.006), (I-655)+(1.038)+(5.007), (I-655)+(1.038)+(5.008), (I-655)+(1.038)+(5.009), (I-655)+(1.038)+(5.010), (I-655)+(1.038)+(5.011), (I-655)+(1.038)+(5.012), (I-655)+(1.038)+(5.013), (I-655)+(1.038)+(5.014), (I-655)+(1.038)+(5.015), (I-655)+(1.038)+(5.016), (I-655)+(1.038)+(5.017), (I-655)+(1.038)+(5.018), (I-655)+(1.038)+(5.019), (I-655)+(1.038)+(5.020), (I-655)+(1.038)+(5.021), (I-655)+(1.038)+(5.022), (I-655)+(1.038)+(5.023), (I-655)+(1.038)+(6.001), (I-655)+(1.038)+(6.002), (I-655)+(1.038)+(6.003), (I-655)+(1.038)+(6.004), (I-655)+(1.038)+(7.001), (I-655)+(1.038)+(7.002), (I-655)+(1.038)+(7.003), (I-655)+(1.038)+(7.004), (I-655)+(1.038)+(7.005), (I-655)+(1.038)+(7.006), (I-655)+(1.038)+(9.001), (I-655)+(1.038)+(9.002), (I-655)+(1.038)+(9.003), (I-655)+(1.038)+(9.004), (I-655)+(1.038)+(9.005), (I-655)+(1.038)+(9.006), (I-655)+(1.038)+(9.007), (I-655)+(1.038)+(9.008), (I-655)+(1.038)+(9.009), (I-655)+(1.038)+(14.001), (I-655)+(1.038)+(14.002), (I-655)+(1.038)+(15.008), (I-655)+(1.038)+(15.011), (I-655)+(1.038)+(15.012), (I-655)+(1.038)+(15.016), (I-655)+(1.038)+(15.025), (I-655)+(1.038)+(15.027), (I-655)+(1.038)+(15.047), (I-655)+(1.038)+(15.063), (I-655)+(1.038)+(15.064), (I-655)+(1.038)+(16.001), (I-655)+(1.038)+(16.002), (I-655)+(1.038)+(16.003), (I-655)+(1.038)+(16.004), (I-655)+(1.038)+(16.005), (I-655)+(1.038)+(16.006), (I-655)+(1.038)+(16.007), (I-655)+(1.038)+(16.008), (I-655)+(1.038)+(17.001), (I-655)+(1.038)+(17.002), (I-655)+(1.038)+(17.003), (I-655)+(1.038)+(17.004), (I-655)+(1.038)+(17.005), (I-655)+(1.038)+(17.006), (I-655)+(1.038)+(17.007), (I-655)+(1.038)+(17.008), (I-655)+(1.038)+(17.009), (I-655)+(1.038)+(17.010), (I-655)+(1.038)+(17.011), (I-655)+(1.038)+(17.012), (I-655)+(1.038)+(18.001),

(I-655)+(1.039)+(1.040), (I-655)+(1.039)+(1.041), (I-655)+(1.039)+(1.042), (I-655)+(1.039)+(1.043), (I-655)+(1.039)+(1.044), (I-655)+(1.039)+(1.045), (I-655)+(1.039)+(1.046), (I-655)+(1.039)+(1.047), (I-655)+(1.039)+(1.048), (I-655)+(1.039)+(1.049), (I-655)+(1.039)+(1.050), (I-655)+(1.039)+(1.051), (I-655)+(1.039)+(1.052), (I-655)+(1.039)+(1.053), (I-655)+(1.039)+(1.054), (I-655)+(1.039)+(1.055), (I-655)+(1.039)+(1.056), (I-655)+(1.039)+(1.057), (I-655)+(1.039)+(1.058), (I-655)+(1.039)+(1.059), (I-655)+(1.039)+(1.060), (I-655)+(1.039)+(1.061), (I-655)+(1.039)+(1.062), (I-655)+(1.039)+(1.063), (I-655)+(1.039)+(1.064), (I-655)+(1.039)+(1.065), (I-655)+(1.039)+(1.066), (I-655)+(1.039)+(1.067), (I-655)+(1.039)+(1.068), (I-655)+(1.039)+(1.069), (I-655)+(1.039)+(1.070), (I-655)+(1.039)+(1.071), (I-655)+(1.039)+(1.072), (I-655)+(1.039)+(1.073), (I-655)+(1.039)+(1.074), (I-655)+(1.039)+(1.075), (I-655)+(1.039)+(1.076), (I-655)+(1.039)+(1.077), (I-655)+(1.039)+(1.078), (I-655)+(1.039)+(1.079), (I-655)+(1.039)+(1.080), (I-655)+(1.039)+(1.081), (I-655)+(1.039)+(1.082), (I-655)+(1.039)+(1.083), (I-655)+(1.039)+(1.084), (I-655)+(1.039)+(1.085), (I-655)+(1.039)+(1.086), (I-655)+(1.039)+(1.087), (I-655)+(1.039)+(1.088), (I-655)+(1.039)+(1.089), (I-655)+(1.039)+(1.090), (I-655)+(1.039)+(1.091), (I-655)+(1.039)+(1.092), (I-655)+(1.039)+(2.001), (I-655)+(1.039)+(2.002), (I-655)+(1.039)+(2.003), (I-655)+(1.039)+(2.004), (I-655)+(1.039)+(2.005), (I-655)+(1.039)+(2.006), (I-655)+(1.039)+(2.007), (I-655)+(1.039)+(2.008), (I-655)+(1.039)+(2.009), (I-655)+(1.039)+(2.010), (I-655)+(1.039)+(2.011), (I-655)+(1.039)+(2.012), (I-655)+(1.039)+(2.013), (I-655)+(1.039)+(2.014), (I-655)+(1.039)+(2.015), (I-655)+(1.039)+(2.016), (I-655)+(1.039)+(2.017), (I-655)+(1.039)+(2.018), (I-655)+(1.039)+(2.019), (I-655)+(1.039)+(2.020), (I-655)+(1.039)+(2.021), (I-655)+(1.039)+(2.022), (I-655)+(1.039)+(2.023), (I-655)+(1.039)+(2.024), (I-655)+(1.039)+(2.025), (I-655)+(1.039)+(2.026), (I-655)+(1.039)+(2.027), (I-655)+(1.039)+(2.028), (I-655)+(1.039)+(2.029), (I-655)+(1.039)+(2.030), (I-655)+(1.039)+(2.031), (I-655)+(1.039)+(2.032), (I-655)+(1.039)+(2.033), (I-655)+(1.039)+(2.034), (I-655)+(1.039)+(2.035), (I-655)+(1.039)+(2.036), (I-655)+(1.039)+(2.037), (I-655)+(1.039)+(2.038), (I-655)+(1.039)+(2.039), (I-655)+(1.039)+(2.040), (I-655)+(1.039)+(2.041), (I-655)+(1.039)+(2.042), (I-655)+(1.039)+(2.043), (I-655)+(1.039)+(2.044), (I-655)+(1.039)+(2.045), (I-655)+(1.039)+(2.046), (I-655)+(1.039)+(2.047), (I-655)+(1.039)+(2.048), (I-655)+(1.039)+(2.049), (I-655)+(1.039)+(2.050), (I-655)+(1.039)+(2.051), (I-655)+(1.039)+(2.052), (I-655)+(1.039)+(2.053), (I-655)+(1.039)+(2.054), (I-655)+(1.039)+(2.055), (I-655)+(1.039)+(2.056), (I-655)+(1.039)+(2.057), (I-655)+(1.039)+(2.058), (I-655)+(1.039)+(2.059), (I-655)+(1.039)+(3.001), (I-655)+(1.039)+(3.002), (I-655)+(1.039)+(3.003), (I-655)+(1.039)+(3.004), (I-655)+(1.039)+(3.005), (I-655)+(1.039)+(3.006), (I-655)+(1.039)+(3.007), (I-655)+(1.039)+(3.008), (I-655)+(1.039)+(3.009), (I-655)+(1.039)+(3.010), (I-655)+(1.039)+(3.011), (I-655)+(1.039)+(3.012), (I-655)+(1.039)+(3.013), (I-655)+(1.039)+(3.014), (I-655)+(1.039)+(3.015), (I-655)+(1.039)+(3.016), (I-655)+(1.039)+(3.017), (I-655)+(1.039)+(3.018), (I-655)+(1.039)+(3.019), (I-655)+(1.039)+(3.020), (I-655)+(1.039)+(3.021), (I-655)+(1.039)+(3.022), (I-655)+(1.039)+(3.023), (I-655)+(1.039)+(3.024), (I-655)+(1.039)+(3.025), (I-655)+(1.039)+(3.026), (I-655)+(1.039)+(3.027), (I-655)+(1.039)+(3.028), (I-655)+(1.039)+(3.029), (I-655)+(1.039)+(3.030), (I-655)+(1.039)+(3.031), (I-655)+(1.039)+(5.001), (I-655)+(1.039)+(5.002), (I-655)+(1.039)+(5.003), (I-655)+(1.039)+(5.004), (I-655)+(1.039)+(5.005), (I-655)+(1.039)+(5.006), (I-655)+(1.039)+(5.007), (I-655)+(1.039)+(5.008), (I-655)+(1.039)+(5.009), (I-655)+(1.039)+(5.010), (I-655)+(1.039)+(5.011), (I-655)+(1.039)+(5.012), (I-655)+(1.039)+(5.013), (I-655)+(1.039)+(5.014), (I-655)+(1.039)+(5.015), (I-655)+(1.039)+(5.016), (I-655)+(1.039)+(5.017), (I-655)+(1.039)+(5.018), (I-655)+(1.039)+(5.019), (I-655)+(1.039)+(5.020), (I-655)+(1.039)+(5.021), (I-655)+(1.039)+(5.022), (I-655)+(1.039)+(5.023), (I-655)+(1.039)+(6.001), (I-655)+(1.039)+(6.002), (I-655)+(1.039)+(6.003), (I-655)+(1.039)+(6.004), (I-655)+(1.039)+(7.001), (I-655)+(1.039)+(7.002), (I-655)+(1.039)+(7.003), (I-655)+(1.039)+(7.004), (I-655)+(1.039)+(7.005), (I-655)+(1.039)+(7.006), (I-655)+(1.039)+(9.001), (I-655)+(1.039)+(9.002), (I-655)+(1.039)+(9.003), (I-655)+(1.039)+(9.004), (I-655)+(1.039)+(9.005), (I-655)+(1.039)+(9.006), (I-655)+(1.039)+(9.007), (I-655)+(1.039)+(9.008), (I-655)+(1.039)+(9.009), (I-655)+(1.039)+(14.001), (I-655)+(1.039)+(14.002), (I-655)+(1.039)+(15.008), (I-655)+(1.039)+(15.011), (I-655)+(1.039)+(15.012), (I-655)+(1.039)+(15.016), (I-655)+(1.039)+(15.025), (I-655)+(1.039)+(15.027), (I-655)+(1.039)+(15.047), (I-655)+(1.039)+(15.063), (I-655)+(1.039)+(15.064), (I-655)+(1.039)+(16.001), (I-655)+(1.039)+(16.002), (I-655)+(1.039)+(16.003), (I-655)+(1.039)+(16.004), (I-655)+(1.039)+(16.005), (I-655)+(1.039)+(16.006), (I-655)+(1.039)+(16.007), (I-655)+(1.039)+(16.008), (I-655)+(1.039)+(17.001), (I-655)+(1.039)+(17.002), (I-655)+(1.039)+(17.003), (I-655)+(1.039)+(17.004), (I-655)+(1.039)+(17.005), (I-655)+(1.039)+(17.006), (I-655)+(1.039)+(17.007), (I-655)+(1.039)+(17.008), (I-655)+(1.039)+(17.009), (I-655)+(1.039)+(17.010), (I-655)+(1.039)+(17.011), (I-655)+(1.039)+(17.012), (I-655)+(1.039)+(18.001),

(I-655)+(1.040)+(1.041), (I-655)+(1.040)+(1.042), (I-655)+(1.040)+(1.043), (I-655)+(1.040)+(1.044), (I-655)+(1.040)+(1.045), (I-655)+(1.040)+(1.046), (I-655)+(1.040)+(1.047), (I-655)+(1.040)+(1.048), (I-655)+(1.040)+(1.049), (I-655)+(1.040)+(1.050), (I-655)+(1.040)+(1.051), (I-655)+(1.040)+(1.052), (I-655)+(1.040)+(1.053), (I-655)+(1.040)+(1.054), (I-655)+(1.040)+(1.055), (I-655)+(1.040)+(1.056), (I-655)+(1.040)+(1.057), (I-655)+(1.040)+(1.058), (I-655)+(1.040)+(1.059), (I-655)+(1.040)+(1.060), (I-655)+(1.040)+(1.061), (I-655)+(1.040)+(1.062), (I-655)+(1.040)+(1.063), (I-655)+(1.040)+(1.064), (I-655)+(1.040)+(1.065), (I-655)+(1.040)+(1.066), (I-655)+(1.040)+(1.067), (I-655)+(1.040)+(1.068), (I-655)+(1.040)+(1.069), (I-655)+(1.040)+(1.070), (I-655)+(1.040)+(1.071), (I-655)+(1.040)+(1.072), (I-655)+(1.040)+(1.073), (I-655)+(1.040)+(1.074), (I-655)+(1.040)+(1.075), (I-655)+(1.040)+(1.076), (I-655)+(1.040)+(1.077), (I-655)+(1.040)+(1.078), (I-655)+(1.040)+(1.079), (I-655)+(1.040)+(1.080), (I-655)+(1.040)+(1.081), (I-655)+(1.040)+(1.082), (I-655)+(1.040)+(1.083), (I-655)+(1.040)+(1.084), (I-655)+(1.040)+(1.085), (I-655)+(1.040)+(1.086), (I-655)+(1.040)+(1.087), (I-655)+(1.040)+(1.088), (I-655)+(1.040)+(1.089), (I-655)+(1.040)+(1.090), (I-655)+(1.040)+(1.091), (I-655)+(1.040)+(1.092), (I-655)+(1.040)+(2.001), (I-655)+(1.040)+(2.002), (I-655)+(1.040)+(2.003), (I-655)+(1.040)+(2.004), (I-655)+(1.040)+(2.005), (I-655)+(1.040)+(2.006), (I-655)+(1.040)+(2.007), (I-655)+(1.040)+(2.008), (I-655)+(1.040)+(2.009), (I-655)+(1.040)+(2.010), (I-655)+(1.040)+(2.011), (I-655)+(1.040)+(2.012), (I-655)+(1.040)+(2.013), (I-655)+(1.040)+(2.014), (I-655)+(1.040)+(2.015), (I-655)+(1.040)+(2.016), (I-655)+(1.040)+(2.017), (I-655)+(1.040)+(2.018), (I-655)+(1.040)+(2.019), (I-655)+(1.040)+(2.020), (I-655)+(1.040)+(2.021), (I-655)+(1.040)+(2.022), (I-655)+(1.040)+(2.023), (I-655)+(1.040)+(2.024), (I-655)+(1.040)+(2.025), (I-655)+(1.040)+(2.026), (I-655)+(1.040)+(2.027), (I-655)+(1.040)+(2.028), (I-655)+(1.040)+(2.029), (I-655)+(1.040)+(2.030), (I-655)+(1.040)+(2.031), (I-655)+(1.040)+(2.032), (I-655)+(1.040)+(2.033), (I-655)+(1.040)+(2.034), (I-655)+(1.040)+(2.035), (I-655)+(1.040)+(2.036), (I-655)+(1.040)+(2.037), (I-655)+(1.040)+(2.038), (I-655)+(1.040)+(2.039), (I-655)+(1.040)+(2.040), (I-655)+(1.040)+(2.041), (I-655)+(1.040)+(2.042), (I-655)+(1.040)+(2.043), (I-655)+(1.040)+(2.044), (I-655)+(1.040)+(2.045), (I-655)+(1.040)+(2.046), (I-655)+(1.040)+(2.047), (I-655)+(1.040)+(2.048), (I-655)+(1.040)+(2.049), (I-655)+(1.040)+(2.050), (I-655)+(1.040)+(2.051), (I-655)+(1.040)+(2.052), (I-655)+(1.040)+(2.053), (I-655)+(1.040)+(2.054), (I-655)+(1.040)+(2.055), (I-655)+(1.040)+(2.056), (I-655)+(1.040)+(2.057), (I-655)+(1.040)+(2.058), (I-655)+(1.040)+(2.059), (I-655)+(1.040)+(3.001), (I-655)+(1.040)+(3.002), (I-655)+(1.040)+(3.003), (I-655)+(1.040)+(3.004), (I-655)+(1.040)+(3.005), (I-655)+(1.040)+(3.006), (I-655)+(1.040)+(3.007), (I-655)+(1.040)+(3.008), (I-655)+(1.040)+(3.009), (I-655)+(1.040)+(3.010), (I-655)+(1.040)+(3.011), (I-655)+(1.040)+(3.012), (I-655)+(1.040)+(3.013), (I-655)+(1.040)+(3.014), (I-655)+(1.040)+(3.015), (I-655)+(1.040)+(3.016), (I-655)+(1.040)+(3.017), (I-655)+(1.040)+(3.018), (I-655)+(1.040)+(3.019), (I-655)+(1.040)+(3.020), (I-655)+(1.040)+(3.021), (I-655)+(1.040)+(3.022), (I-655)+(1.040)+(3.023), (I-655)+(1.040)+(3.024), (I-655)+(1.040)+(3.025), (I-655)+(1.040)+(3.026), (I-655)+(1.040)+(3.027), (I-655)+(1.040)+(3.028), (I-655)+(1.040)+(3.029), (I-655)+(1.040)+(3.030), (I-655)+(1.040)+(3.031), (I-655)+(1.040)+(5.001), (I-655)+(1.040)+(5.002), (I-655)+(1.040)+(5.003), (I-655)+(1.040)+(5.004), (I-655)+(1.040)+(5.005), (I-655)+(1.040)+(5.006), (I-655)+(1.040)+(5.007), (I-655)+(1.040)+(5.008), (I-655)+(1.040)+(5.009), (I-655)+(1.040)+(5.010), (I-655)+(1.040)+(5.011), (I-655)+(1.040)+(5.012), (I-655)+(1.040)+(5.013), (I-655)+(1.040)+(5.014), (I-655)+(1.040)+(5.015), (I-655)+(1.040)+(5.016), (I-655)+(1.040)+(5.017), (I-655)+(1.040)+(5.018), (I-655)+(1.040)+(5.019), (I-655)+(1.040)+(5.020), (I-655)+(1.040)+(5.021), (I-655)+(1.040)+(5.022), (I-655)+(1.040)+(5.023), (I-655)+(1.040)+(6.001), (I-655)+(1.040)+(6.002), (I-655)+(1.040)+(6.003), (I-655)+(1.040)+(6.004), (I-655)+(1.040)+(7.001), (I-655)+(1.040)+(7.002), (I-655)+(1.040)+(7.003), (I-655)+(1.040)+(7.004), (I-655)+(1.040)+(7.005), (I-655)+(1.040)+(7.006), (I-655)+(1.040)+(9.001), (I-655)+(1.040)+(9.002), (I-655)+(1.040)+(9.003), (I-655)+(1.040)+(9.004), (I-655)+(1.040)+(9.005), (I-655)+(1.040)+(9.006), (I-655)+(1.040)+(9.007), (I-655)+(1.040)+(9.008), (I-655)+(1.040)+(9.009), (I-655)+(1.040)+(14.001), (I-655)+(1.040)+(14.002), (I-655)+(1.040)+(15.008), (I-655)+(1.040)+(15.011), (I-655)+(1.040)+(15.012), (I-655)+(1.040)+(15.016), (I-655)+(1.040)+(15.025), (I-655)+(1.040)+(15.027), (I-655)+(1.040)+(15.047), (I-655)+(1.040)+(15.063), (I-655)+(1.040)+(15.064), (I-655)+(1.040)+(16.001), (I-655)+(1.040)+(16.002), (I-655)+(1.040)+(16.003), (I-655)+(1.040)+(16.004), (I-655)+(1.040)+(16.005), (I-655)+(1.040)+(16.006), (I-655)+(1.040)+(16.007), (I-655)+(1.040)+(16.008), (I-655)+(1.040)+(17.001), (I-655)+(1.040)+(17.002), (I-655)+(1.040)+(17.003), (I-655)+(1.040)+(17.004), (I-655)+(1.040)+(17.005), (I-655)+(1.040)+(17.006), (I-655)+(1.040)+(17.007), (I-655)+(1.040)+(17.008), (I-655)+(1.040)+(17.009), (I-655)+(1.040)+(17.010), (I-655)+(1.040)+(17.011), (I-655)+(1.040)+(17.012), (I-655)+(1.040)+(18.001),

(I-655)+(1.041)+(1.042), (I-655)+(1.041)+(1.043), (I-655)+(1.041)+(1.044), (I-655)+(1.041)+(1.045), (I-655)+(1.041)+(1.046), (I-655)+(1.041)+(1.047), (I-655)+(1.041)+(1.048), (I-655)+(1.041)+(1.049), (I-655)+(1.041)+(1.050), (I-655)+(1.041)+(1.051), (I-655)+(1.041)+(1.052), (I-655)+(1.041)+(1.053), (I-655)+(1.041)+(1.054), (I-655)+(1.041)+(1.055), (I-655)+(1.041)+(1.056), (I-655)+(1.041)+(1.057), (I-655)+(1.041)+(1.058), (I-655)+(1.041)+(1.059), (I-655)+(1.041)+(1.060), (I-655)+(1.041)+(1.061), (I-655)+(1.041)+(1.062), (I-655)+(1.041)+(1.063), (I-655)+(1.041)+(1.064), (I-655)+(1.041)+(1.065), (I-655)+(1.041)+(1.066), (I-655)+(1.041)+(1.067), (I-655)+(1.041)+(1.068), (I-655)+(1.041)+(1.069), (I-655)+(1.041)+(1.070), (I-655)+(1.041)+(1.071), (I-655)+(1.041)+(1.072), (I-655)+(1.041)+(1.073), (I-655)+(1.041)+(1.074), (I-655)+(1.041)+(1.075), (I-655)+(1.041)+(1.076), (I-655)+(1.041)+(1.077), (I-655)+(1.041)+(1.078), (I-655)+(1.041)+(1.079), (I-655)+(1.041)+(1.080), (I-655)+(1.041)+(1.081), (I-655)+(1.041)+(1.082), (I-655)+(1.041)+(1.083), (I-655)+(1.041)+(1.084), (I-655)+(1.041)+(1.085), (I-655)+(1.041)+(1.086), (I-655)+(1.041)+(1.087), (I-655)+(1.041)+(1.088), (I-655)+(1.041)+(1.089), (I-655)+(1.041)+(1.090), (I-655)+(1.041)+(1.091), (I-655)+(1.041)+(1.092), (I-655)+(1.041)+(2.001), (I-655)+(1.041)+(2.002), (I-655)+(1.041)+(2.003), (I-655)+(1.041)+(2.004), (I-655)+(1.041)+(2.005), (I-655)+(1.041)+(2.006), (I-655)+(1.041)+(2.007), (I-655)+(1.041)+(2.008), (I-655)+(1.041)+(2.009), (I-655)+(1.041)+(2.010), (I-655)+(1.041)+(2.011), (I-655)+(1.041)+(2.012), (I-655)+(1.041)+(2.013), (I-655)+(1.041)+(2.014), (I-655)+(1.041)+(2.015), (I-655)+(1.041)+(2.016), (I-655)+(1.041)+(2.017), (I-655)+(1.041)+(2.018), (I-655)+(1.041)+(2.019), (I-655)+(1.041)+(2.020), (I-655)+(1.041)+(2.021), (I-655)+(1.041)+(2.022), (I-655)+(1.041)+(2.023), (I-655)+(1.041)+(2.024), (I-655)+(1.041)+(2.025), (I-655)+(1.041)+(2.026), (I-655)+(1.041)+(2.027), (I-655)+(1.041)+(2.028), (I-655)+(1.041)+(2.029), (I-655)+(1.041)+(2.030), (I-655)+(1.041)+(2.031), (I-655)+(1.041)+(2.032), (I-655)+(1.041)+(2.033), (I-655)+(1.041)+(2.034), (I-655)+(1.041)+(2.035), (I-655)+(1.041)+(2.036), (I-655)+(1.041)+(2.037), (I-655)+(1.041)+(2.038), (I-655)+(1.041)+(2.039), (I-655)+(1.041)+(2.040), (I-655)+(1.041)+(2.041), (I-655)+(1.041)+(2.042), (I-655)+(1.041)+(2.043), (I-655)+(1.041)+(2.044), (I-655)+(1.041)+(2.045), (I-655)+(1.041)+(2.046), (I-655)+(1.041)+(2.047), (I-655)+(1.041)+(2.048), (I-655)+(1.041)+(2.049), (I-655)+(1.041)+(2.050), (I-655)+(1.041)+(2.051), (I-655)+(1.041)+(2.052), (I-655)+(1.041)+(2.053), (I-655)+(1.041)+(2.054), (I-655)+(1.041)+(2.055), (I-655)+(1.041)+(2.056), (I-655)+(1.041)+(2.057), (I-655)+(1.041)+(2.058), (I-655)+(1.041)+(2.059), (I-655)+(1.041)+(3.001), (I-655)+(1.041)+(3.002), (I-655)+(1.041)+(3.003), (I-655)+(1.041)+(3.004), (I-655)+(1.041)+(3.005), (I-655)+(1.041)+(3.006), (I-655)+(1.041)+(3.007), (I-655)+(1.041)+(3.008), (I-655)+(1.041)+(3.009), (I-655)+(1.041)+(3.010), (I-655)+(1.041)+(3.011), (I-655)+(1.041)+(3.012), (I-655)+(1.041)+(3.013), (I-655)+(1.041)+(3.014), (I-655)+(1.041)+(3.015), (I-655)+(1.041)+(3.016), (I-655)+(1.041)+(3.017), (I-655)+(1.041)+(3.018), (I-655)+(1.041)+(3.019), (I-655)+(1.041)+(3.020), (I-655)+(1.041)+(3.021), (I-655)+(1.041)+(3.022), (I-655)+(1.041)+(3.023), (I-655)+(1.041)+(3.024), (I-655)+(1.041)+(3.025), (I-655)+(1.041)+(3.026), (I-655)+(1.041)+(3.027), (I-655)+(1.041)+(3.028), (I-655)+(1.041)+(3.029), (I-655)+(1.041)+(3.030), (I-655)+(1.041)+(3.031), (I-655)+(1.041)+(5.001), (I-655)+(1.041)+(5.002), (I-655)+(1.041)+(5.003), (I-655)+(1.041)+(5.004), (I-655)+(1.041)+(5.005), (I-655)+(1.041)+(5.006), (I-655)+(1.041)+(5.007), (I-655)+(1.041)+(5.008), (I-655)+(1.041)+(5.009), (I-655)+(1.041)+(5.010), (I-655)+(1.041)+(5.011), (I-655)+(1.041)+(5.012), (I-655)+(1.041)+(5.013), (I-655)+(1.041)+(5.014), (I-655)+(1.041)+(5.015), (I-655)+(1.041)+(5.016), (I-655)+(1.041)+(5.017), (I-655)+(1.041)+(5.018), (I-655)+(1.041)+(5.019), (I-655)+(1.041)+(5.020), (I-655)+(1.041)+(5.021), (I-655)+(1.041)+(5.022), (I-655)+(1.041)+(5.023), (I-655)+(1.041)+(6.001), (I-655)+(1.041)+(6.002), (I-655)+(1.041)+(6.003), (I-655)+(1.041)+(6.004), (I-655)+(1.041)+(7.001), (I-655)+(1.041)+(7.002), (I-655)+(1.041)+(7.003), (I-655)+(1.041)+(7.004), (I-655)+(1.041)+(7.005), (I-655)+(1.041)+(7.006), (I-655)+(1.041)+(9.001), (I-655)+(1.041)+(9.002), (I-655)+(1.041)+(9.003), (I-655)+(1.041)+(9.004), (I-655)+(1.041)+(9.005), (I-655)+(1.041)+(9.006), (I-655)+(1.041)+(9.007), (I-655)+(1.041)+(9.008), (I-655)+(1.041)+(9.009), (I-655)+(1.041)+(14.001), (I-655)+(1.041)+(14.002), (I-655)+(1.041)+(15.008), (I-655)+(1.041)+(15.011), (I-655)+(1.041)+(15.012), (I-655)+(1.041)+(15.016), (I-655)+(1.041)+(15.025), (I-655)+(1.041)+(15.027), (I-655)+(1.041)+(15.047), (I-655)+(1.041)+(15.063), (I-655)+(1.041)+(15.064), (I-655)+(1.041)+(16.001), (I-655)+(1.041)+(16.002), (I-655)+(1.041)+(16.003), (I-655)+(1.041)+(16.004), (I-655)+(1.041)+(16.005), (I-655)+(1.041)+(16.006), (I-655)+(1.041)+(16.007), (I-655)+(1.041)+(16.008), (I-655)+(1.041)+(17.001), (I-655)+(1.041)+(17.002), (I-655)+(1.041)+(17.003), (I-655)+(1.041)+(17.004), (I-655)+(1.041)+(17.005), (I-655)+(1.041)+(17.006), (I-655)+(1.041)+(17.007), (I-655)+(1.041)+(17.008), (I-655)+(1.041)+(17.009), (I-655)+(1.041)+(17.010), (I-655)+(1.041)+(17.011), (I-655)+(1.041)+(17.012), (I-655)+(1.041)+(18.001),

(I-655)+(1.042)+(1.043), (I-655)+(1.042)+(1.044), (I-655)+(1.042)+(1.045), (I-655)+(1.042)+(1.046), (I-655)+(1.042)+(1.047), (I-655)+(1.042)+(1.048), (I-655)+(1.042)+(1.049), (I-655)+(1.042)+(1.050), (I-655)+(1.042)+(1.051), (I-655)+(1.042)+(1.052), (I-655)+(1.042)+(1.053), (I-655)+(1.042)+(1.054), (I-655)+(1.042)+(1.055), (I-655)+(1.042)+(1.056), (I-655)+(1.042)+(1.057), (I-655)+(1.042)+(1.058), (I-655)+(1.042)+(1.059), (I-655)+(1.042)+(1.060), (I-655)+(1.042)+(1.061), (I-655)+(1.042)+(1.062), (I-655)+(1.042)+(1.063), (I-655)+(1.042)+(1.064), (I-655)+(1.042)+(1.065), (I-655)+(1.042)+(1.066), (I-655)+(1.042)+(1.067), (I-655)+(1.042)+(1.068), (I-655)+(1.042)+(1.069), (I-655)+(1.042)+(1.070), (I-655)+(1.042)+(1.071), (I-655)+(1.042)+(1.072), (I-655)+(1.042)+(1.073), (I-655)+(1.042)+(1.074), (I-655)+(1.042)+(1.075), (I-655)+(1.042)+(1.076), (I-655)+(1.042)+(1.077), (I-655)+(1.042)+(1.078), (I-655)+(1.042)+(1.079), (I-655)+(1.042)+(1.080), (I-655)+(1.042)+(1.081), (I-655)+(1.042)+(1.082), (I-655)+(1.042)+(1.083), (I-655)+(1.042)+(1.084), (I-655)+(1.042)+(1.085), (I-655)+(1.042)+(1.086), (I-655)+(1.042)+(1.087), (I-655)+(1.042)+(1.088), (I-655)+(1.042)+(1.089), (I-655)+(1.042)+(1.090), (I-655)+(1.042)+(1.091), (I-655)+(1.042)+(1.092), (I-655)+(1.042)+(2.001), (I-655)+(1.042)+(2.002), (I-655)+(1.042)+(2.003), (I-655)+(1.042)+(2.004), (I-655)+(1.042)+(2.005), (I-655)+(1.042)+(2.006), (I-655)+(1.042)+(2.007), (I-655)+(1.042)+(2.008), (I-655)+(1.042)+(2.009), (I-655)+(1.042)+(2.010), (I-655)+(1.042)+(2.011), (I-655)+(1.042)+(2.012), (I-655)+(1.042)+(2.013), (I-655)+(1.042)+(2.014), (I-655)+(1.042)+(2.015), (I-655)+(1.042)+(2.016), (I-655)+(1.042)+(2.017), (I-655)+(1.042)+(2.018), (I-655)+(1.042)+(2.019), (I-655)+(1.042)+(2.020), (I-655)+(1.042)+(2.021), (I-655)+(1.042)+(2.022), (I-655)+(1.042)+(2.023), (I-655)+(1.042)+(2.024), (I-655)+(1.042)+(2.025), (I-655)+(1.042)+(2.026), (I-655)+(1.042)+(2.027), (I-655)+(1.042)+(2.028), (I-655)+(1.042)+(2.029), (I-655)+(1.042)+(2.030), (I-655)+(1.042)+(2.031), (I-655)+(1.042)+(2.032), (I-655)+(1.042)+(2.033), (I-655)+(1.042)+(2.034), (I-655)+(1.042)+(2.035), (I-655)+(1.042)+(2.036), (I-655)+(1.042)+(2.037), (I-655)+(1.042)+(2.038), (I-655)+(1.042)+(2.039), (I-655)+(1.042)+(2.040), (I-655)+(1.042)+(2.041), (I-655)+(1.042)+(2.042), (I-655)+(1.042)+(2.043), (I-655)+(1.042)+(2.044), (I-655)+(1.042)+(2.045), (I-655)+(1.042)+(2.046), (I-655)+(1.042)+(2.047), (I-655)+(1.042)+(2.048), (I-655)+(1.042)+(2.049), (I-655)+(1.042)+(2.050), (I-655)+(1.042)+(2.051), (I-655)+(1.042)+(2.052), (I-655)+(1.042)+(2.053), (I-655)+(1.042)+(2.054), (I-655)+(1.042)+(2.055), (I-655)+(1.042)+(2.056), (I-655)+(1.042)+(2.057), (I-655)+(1.042)+(2.058), (I-655)+(1.042)+(2.059), (I-655)+(1.042)+(3.001), (I-655)+(1.042)+(3.002), (I-655)+(1.042)+(3.003), (I-655)+(1.042)+(3.004), (I-655)+(1.042)+(3.005), (I-655)+(1.042)+(3.006), (I-655)+(1.042)+(3.007), (I-655)+(1.042)+(3.008), (I-655)+(1.042)+(3.009), (I-655)+(1.042)+(3.010), (I-655)+(1.042)+(3.011), (I-655)+(1.042)+(3.012), (I-655)+(1.042)+(3.013), (I-655)+(1.042)+(3.014), (I-655)+(1.042)+(3.015), (I-655)+(1.042)+(3.016), (I-655)+(1.042)+(3.017), (I-655)+(1.042)+(3.018), (I-655)+(1.042)+(3.019), (I-655)+(1.042)+(3.020), (I-655)+(1.042)+(3.021), (I-655)+(1.042)+(3.022), (I-655)+(1.042)+(3.023), (I-655)+(1.042)+(3.024), (I-655)+(1.042)+(3.025), (I-655)+(1.042)+(3.026), (I-655)+(1.042)+(3.027), (I-655)+(1.042)+(3.028), (I-655)+(1.042)+(3.029), (I-655)+(1.042)+(3.030), (I-655)+(1.042)+(3.031), (I-655)+(1.042)+(5.001), (I-655)+(1.042)+(5.002), (I-655)+(1.042)+(5.003), (I-655)+(1.042)+(5.004), (I-655)+(1.042)+(5.005), (I-655)+(1.042)+(5.006), (I-655)+(1.042)+(5.007), (I-655)+(1.042)+(5.008), (I-655)+(1.042)+(5.009), (I-655)+(1.042)+(5.010), (I-655)+(1.042)+(5.011), (I-655)+(1.042)+(5.012), (I-655)+(1.042)+(5.013), (I-655)+(1.042)+(5.014), (I-655)+(1.042)+(5.015), (I-655)+(1.042)+(5.016), (I-655)+(1.042)+(5.017), (I-655)+(1.042)+(5.018), (I-655)+(1.042)+(5.019), (I-655)+(1.042)+(5.020), (I-655)+(1.042)+(5.021), (I-655)+(1.042)+(5.022), (I-655)+(1.042)+(5.023), (I-655)+(1.042)+(6.001), (I-655)+(1.042)+(6.002), (I-655)+(1.042)+(6.003), (I-655)+(1.042)+(6.004), (I-655)+(1.042)+(7.001), (I-655)+(1.042)+(7.002), (I-655)+(1.042)+(7.003), (I-655)+(1.042)+(7.004), (I-655)+(1.042)+(7.005), (I-655)+(1.042)+(7.006), (I-655)+(1.042)+(9.001), (I-655)+(1.042)+(9.002), (I-655)+(1.042)+(9.003), (I-655)+(1.042)+(9.004), (I-655)+(1.042)+(9.005), (I-655)+(1.042)+(9.006), (I-655)+(1.042)+(9.007), (I-655)+(1.042)+(9.008), (I-655)+(1.042)+(9.009), (I-655)+(1.042)+(14.001), (I-655)+(1.042)+(14.002), (I-655)+(1.042)+(15.008), (I-655)+(1.042)+(15.011), (I-655)+(1.042)+(15.012), (I-655)+(1.042)+(15.016), (I-655)+(1.042)+(15.025), (I-655)+(1.042)+(15.027), (I-655)+(1.042)+(15.047), (I-655)+(1.042)+(15.063), (I-655)+(1.042)+(15.064), (I-655)+(1.042)+(16.001), (I-655)+(1.042)+(16.002), (I-655)+(1.042)+(16.003), (I-655)+(1.042)+(16.004), (I-655)+(1.042)+(16.005), (I-655)+(1.042)+(16.006), (I-655)+(1.042)+(16.007), (I-655)+(1.042)+(16.008), (I-655)+(1.042)+(17.001), (I-655)+(1.042)+(17.002), (I-655)+(1.042)+(17.003), (I-655)+(1.042)+(17.004), (I-655)+(1.042)+(17.005), (I-655)+(1.042)+(17.006), (I-655)+(1.042)+(17.007), (I-655)+(1.042)+(17.008), (I-655)+(1.042)+(17.009), (I-655)+(1.042)+(17.010), (I-655)+(1.042)+(17.011), (I-655)+(1.042)+(17.012), (I-655)+(1.042)+(18.001),

(I-655)+(1.043)+(1.044), (I-655)+(1.043)+(1.045), (I-655)+(1.043)+(1.046), (I-655)+(1.043)+(1.047), (I-655)+(1.043)+(1.048), (I-655)+(1.043)+(1.049), (I-655)+(1.043)+(1.050), (I-655)+(1.043)+(1.051), (I-655)+(1.043)+(1.052), (I-655)+(1.043)+(1.053), (I-655)+(1.043)+(1.054), (I-655)+(1.043)+(1.055), (I-655)+(1.043)+(1.056), (I-655)+(1.043)+(1.057), (I-655)+(1.043)+(1.058), (I-655)+(1.043)+(1.059), (I-655)+(1.043)+(1.060), (I-655)+(1.043)+(1.061), (I-655)+(1.043)+(1.062), (I-655)+(1.043)+(1.063), (I-655)+(1.043)+(1.064), (I-655)+(1.043)+(1.065), (I-655)+(1.043)+(1.066), (I-655)+(1.043)+(1.067), (I-655)+(1.043)+(1.068), (I-655)+(1.043)+(1.069), (I-655)+(1.043)+(1.070), (I-655)+(1.043)+(1.071), (I-655)+(1.043)+(1.072), (I-655)+(1.043)+(1.073), (I-655)+(1.043)+(1.074), (I-655)+(1.043)+(1.075), (I-655)+(1.043)+(1.076), (I-655)+(1.043)+(1.077), (I-655)+(1.043)+(1.078), (I-655)+(1.043)+(1.079), (I-655)+(1.043)+(1.080), (I-655)+(1.043)+(1.081), (I-655)+(1.043)+(1.082), (I-655)+(1.043)+(1.083), (I-655)+(1.043)+(1.084), (I-655)+(1.043)+(1.085), (I-655)+(1.043)+(1.086), (I-655)+(1.043)+(1.087), (I-655)+(1.043)+(1.088), (I-655)+(1.043)+(1.089), (I-655)+(1.043)+(1.090), (I-655)+(1.043)+(1.091), (I-655)+(1.043)+(1.092), (I-655)+(1.043)+(2.001), (I-655)+(1.043)+(2.002), (I-655)+(1.043)+(2.003), (I-655)+(1.043)+(2.004), (I-655)+(1.043)+(2.005), (I-655)+(1.043)+(2.006), (I-655)+(1.043)+(2.007), (I-655)+(1.043)+(2.008), (I-655)+(1.043)+(2.009), (I-655)+(1.043)+(2.010), (I-655)+(1.043)+(2.011), (I-655)+(1.043)+(2.012), (I-655)+(1.043)+(2.013), (I-655)+(1.043)+(2.014), (I-655)+(1.043)+(2.015), (I-655)+(1.043)+(2.016), (I-655)+(1.043)+(2.017), (I-655)+(1.043)+(2.018), (I-655)+(1.043)+(2.019), (I-655)+(1.043)+(2.020), (I-655)+(1.043)+(2.021), (I-655)+(1.043)+(2.022), (I-655)+(1.043)+(2.023), (I-655)+(1.043)+(2.024), (I-655)+(1.043)+(2.025), (I-655)+(1.043)+(2.026), (I-655)+(1.043)+(2.027), (I-655)+(1.043)+(2.028), (I-655)+(1.043)+(2.029), (I-655)+(1.043)+(2.030), (I-655)+(1.043)+(2.031), (I-655)+(1.043)+(2.032), (I-655)+(1.043)+(2.033), (I-655)+(1.043)+(2.034), (I-655)+(1.043)+(2.035), (I-655)+(1.043)+(2.036), (I-655)+(1.043)+(2.037), (I-655)+(1.043)+(2.038), (I-655)+(1.043)+(2.039), (I-655)+(1.043)+(2.040), (I-655)+(1.043)+(2.041), (I-655)+(1.043)+(2.042), (I-655)+(1.043)+(2.043), (I-655)+(1.043)+(2.044), (I-655)+(1.043)+(2.045), (I-655)+(1.043)+(2.046), (I-655)+(1.043)+(2.047), (I-655)+(1.043)+(2.048), (I-655)+(1.043)+(2.049), (I-655)+(1.043)+(2.050), (I-655)+(1.043)+(2.051), (I-655)+(1.043)+(2.052), (I-655)+(1.043)+(2.053), (I-655)+(1.043)+(2.054), (I-655)+(1.043)+(2.055), (I-655)+(1.043)+(2.056), (I-655)+(1.043)+(2.057), (I-655)+(1.043)+(2.058), (I-655)+(1.043)+(2.059), (I-655)+(1.043)+(3.001), (I-655)+(1.043)+(3.002), (I-655)+(1.043)+(3.003), (I-655)+(1.043)+(3.004), (I-655)+(1.043)+(3.005), (I-655)+(1.043)+(3.006), (I-655)+(1.043)+(3.007), (I-655)+(1.043)+(3.008), (I-655)+(1.043)+(3.009), (I-655)+(1.043)+(3.010), (I-655)+(1.043)+(3.011), (I-655)+(1.043)+(3.012), (I-655)+(1.043)+(3.013), (I-655)+(1.043)+(3.014), (I-655)+(1.043)+(3.015), (I-655)+(1.043)+(3.016), (I-655)+(1.043)+(3.017), (I-655)+(1.043)+(3.018), (I-655)+(1.043)+(3.019), (I-655)+(1.043)+(3.020), (I-655)+(1.043)+(3.021), (I-655)+(1.043)+(3.022), (I-655)+(1.043)+(3.023), (I-655)+(1.043)+(3.024), (I-655)+(1.043)+(3.025), (I-655)+(1.043)+(3.026), (I-655)+(1.043)+(3.027), (I-655)+(1.043)+(3.028), (I-655)+(1.043)+(3.029), (I-655)+(1.043)+(3.030), (I-655)+(1.043)+(3.031), (I-655)+(1.043)+(5.001), (I-655)+(1.043)+(5.002), (I-655)+(1.043)+(5.003), (I-655)+(1.043)+(5.004), (I-655)+(1.043)+(5.005), (I-655)+(1.043)+(5.006), (I-655)+(1.043)+(5.007), (I-655)+(1.043)+(5.008), (I-655)+(1.043)+(5.009), (I-655)+(1.043)+(5.010), (I-655)+(1.043)+(5.011), (I-655)+(1.043)+(5.012), (I-655)+(1.043)+(5.013), (I-655)+(1.043)+(5.014), (I-655)+(1.043)+(5.015), (I-655)+(1.043)+(5.016), (I-655)+(1.043)+(5.017), (I-655)+(1.043)+(5.018), (I-655)+(1.043)+(5.019), (I-655)+(1.043)+(5.020), (I-655)+(1.043)+(5.021), (I-655)+(1.043)+(5.022), (I-655)+(1.043)+(5.023), (I-655)+(1.043)+(6.001), (I-655)+(1.043)+(6.002), (I-655)+(1.043)+(6.003), (I-655)+(1.043)+(6.004), (I-655)+(1.043)+(7.001), (I-655)+(1.043)+(7.002), (I-655)+(1.043)+(7.003), (I-655)+(1.043)+(7.004), (I-655)+(1.043)+(7.005), (I-655)+(1.043)+(7.006), (I-655)+(1.043)+(9.001), (I-655)+(1.043)+(9.002), (I-655)+(1.043)+(9.003), (I-655)+(1.043)+(9.004), (I-655)+(1.043)+(9.005), (I-655)+(1.043)+(9.006), (I-655)+(1.043)+(9.007), (I-655)+(1.043)+(9.008), (I-655)+(1.043)+(9.009), (I-655)+(1.043)+(14.001), (I-655)+(1.043)+(14.002), (I-655)+(1.043)+(15.008), (I-655)+(1.043)+(15.011), (I-655)+(1.043)+(15.012), (I-655)+(1.043)+(15.016), (I-655)+(1.043)+(15.025), (I-655)+(1.043)+(15.027), (I-655)+(1.043)+(15.047), (I-655)+(1.043)+(15.063), (I-655)+(1.043)+(15.064), (I-655)+(1.043)+(16.001), (I-655)+(1.043)+(16.002), (I-655)+(1.043)+(16.003), (I-655)+(1.043)+(16.004), (I-655)+(1.043)+(16.005), (I-655)+(1.043)+(16.006), (I-655)+(1.043)+(16.007), (I-655)+(1.043)+(16.008), (I-655)+(1.043)+(17.001), (I-655)+(1.043)+(17.002), (I-655)+(1.043)+(17.003), (I-655)+(1.043)+(17.004), (I-655)+(1.043)+(17.005), (I-655)+(1.043)+(17.006), (I-655)+(1.043)+(17.007), (I-655)+(1.043)+(17.008), (I-655)+(1.043)+(17.009), (I-655)+(1.043)+(17.010), (I-655)+(1.043)+(17.011), (I-655)+(1.043)+(17.012), (I-655)+(1.043)+(18.001),

(I-655)+(1.044)+(1.045), (I-655)+(1.044)+(1.046), (I-655)+(1.044)+(1.047), (I-655)+(1.044)+(1.048), (I-655)+(1.044)+(1.049), (I-655)+(1.044)+(1.050), (I-655)+(1.044)+(1.051), (I-655)+(1.044)+(1.052), (I-655)+(1.044)+(1.053), (I-655)+(1.044)+(1.054), (I-655)+(1.044)+(1.055), (I-655)+(1.044)+(1.056), (I-655)+(1.044)+(1.057), (I-655)+(1.044)+(1.058), (I-655)+(1.044)+(1.059), (I-655)+(1.044)+(1.060), (I-655)+(1.044)+(1.061), (I-655)+(1.044)+(1.062), (I-655)+(1.044)+(1.063), (I-655)+(1.044)+(1.064), (I-655)+(1.044)+(1.065), (I-655)+(1.044)+(1.066), (I-655)+(1.044)+(1.067), (I-655)+(1.044)+(1.068), (I-655)+(1.044)+(1.069), (I-655)+(1.044)+(1.070), (I-655)+(1.044)+(1.071), (I-655)+(1.044)+(1.072), (I-655)+(1.044)+(1.073), (I-655)+(1.044)+(1.074), (I-655)+(1.044)+(1.075), (I-655)+(1.044)+(1.076), (I-655)+(1.044)+(1.077), (I-655)+(1.044)+(1.078), (I-655)+(1.044)+(1.079), (I-655)+(1.044)+(1.080), (I-655)+(1.044)+(1.081), (I-655)+(1.044)+(1.082), (I-655)+(1.044)+(1.083), (I-655)+(1.044)+(1.084), (I-655)+(1.044)+(1.085), (I-655)+(1.044)+(1.086), (I-655)+(1.044)+(1.087), (I-655)+(1.044)+(1.088), (I-655)+(1.044)+(1.089), (I-655)+(1.044)+(1.090), (I-655)+(1.044)+(1.091), (I-655)+(1.044)+(1.092), (I-655)+(1.044)+(2.001), (I-655)+(1.044)+(2.002), (I-655)+(1.044)+(2.003), (I-655)+(1.044)+(2.004), (I-655)+(1.044)+(2.005), (I-655)+(1.044)+(2.006), (I-655)+(1.044)+(2.007), (I-655)+(1.044)+(2.008), (I-655)+(1.044)+(2.009), (I-655)+(1.044)+(2.010), (I-655)+(1.044)+(2.011), (I-655)+(1.044)+(2.012), (I-655)+(1.044)+(2.013), (I-655)+(1.044)+(2.014), (I-655)+(1.044)+(2.015), (I-655)+(1.044)+(2.016), (I-655)+(1.044)+(2.017), (I-655)+(1.044)+(2.018), (I-655)+(1.044)+(2.019), (I-655)+(1.044)+(2.020), (I-655)+(1.044)+(2.021), (I-655)+(1.044)+(2.022), (I-655)+(1.044)+(2.023), (I-655)+(1.044)+(2.024), (I-655)+(1.044)+(2.025), (I-655)+(1.044)+(2.026), (I-655)+(1.044)+(2.027), (I-655)+(1.044)+(2.028), (I-655)+(1.044)+(2.029), (I-655)+(1.044)+(2.030), (I-655)+(1.044)+(2.031), (I-655)+(1.044)+(2.032), (I-655)+(1.044)+(2.033), (I-655)+(1.044)+(2.034), (I-655)+(1.044)+(2.035), (I-655)+(1.044)+(2.036), (I-655)+(1.044)+(2.037), (I-655)+(1.044)+(2.038), (I-655)+(1.044)+(2.039), (I-655)+(1.044)+(2.040), (I-655)+(1.044)+(2.041), (I-655)+(1.044)+(2.042), (I-655)+(1.044)+(2.043), (I-655)+(1.044)+(2.044), (I-655)+(1.044)+(2.045), (I-655)+(1.044)+(2.046), (I-655)+(1.044)+(2.047), (I-655)+(1.044)+(2.048), (I-655)+(1.044)+(2.049), (I-655)+(1.044)+(2.050), (I-655)+(1.044)+(2.051), (I-655)+(1.044)+(2.052), (I-655)+(1.044)+(2.053), (I-655)+(1.044)+(2.054), (I-655)+(1.044)+(2.055), (I-655)+(1.044)+(2.056), (I-655)+(1.044)+(2.057), (I-655)+(1.044)+(2.058), (I-655)+(1.044)+(2.059), (I-655)+(1.044)+(3.001), (I-655)+(1.044)+(3.002), (I-655)+(1.044)+(3.003), (I-655)+(1.044)+(3.004), (I-655)+(1.044)+(3.005), (I-655)+(1.044)+(3.006), (I-655)+(1.044)+(3.007), (I-655)+(1.044)+(3.008), (I-655)+(1.044)+(3.009), (I-655)+(1.044)+(3.010), (I-655)+(1.044)+(3.011), (I-655)+(1.044)+(3.012), (I-655)+(1.044)+(3.013), (I-655)+(1.044)+(3.014), (I-655)+(1.044)+(3.015), (I-655)+(1.044)+(3.016), (I-655)+(1.044)+(3.017), (I-655)+(1.044)+(3.018), (I-655)+(1.044)+(3.019), (I-655)+(1.044)+(3.020), (I-655)+(1.044)+(3.021), (I-655)+(1.044)+(3.022), (I-655)+(1.044)+(3.023), (I-655)+(1.044)+(3.024), (I-655)+(1.044)+(3.025), (I-655)+(1.044)+(3.026), (I-655)+(1.044)+(3.027), (I-655)+(1.044)+(3.028), (I-655)+(1.044)+(3.029), (I-655)+(1.044)+(3.030), (I-655)+(1.044)+(3.031), (I-655)+(1.044)+(5.001), (I-655)+(1.044)+(5.002), (I-655)+(1.044)+(5.003), (I-655)+(1.044)+(5.004), (I-655)+(1.044)+(5.005), (I-655)+(1.044)+(5.006), (I-655)+(1.044)+(5.007), (I-655)+(1.044)+(5.008), (I-655)+(1.044)+(5.009), (I-655)+(1.044)+(5.010), (I-655)+(1.044)+(5.011), (I-655)+(1.044)+(5.012), (I-655)+(1.044)+(5.013), (I-655)+(1.044)+(5.014), (I-655)+(1.044)+(5.015), (I-655)+(1.044)+(5.016), (I-655)+(1.044)+(5.017), (I-655)+(1.044)+(5.018), (I-655)+(1.044)+(5.019), (I-655)+(1.044)+(5.020), (I-655)+(1.044)+(5.021), (I-655)+(1.044)+(5.022), (I-655)+(1.044)+(5.023), (I-655)+(1.044)+(6.001), (I-655)+(1.044)+(6.002), (I-655)+(1.044)+(6.003), (I-655)+(1.044)+(6.004), (I-655)+(1.044)+(7.001), (I-655)+(1.044)+(7.002), (I-655)+(1.044)+(7.003), (I-655)+(1.044)+(7.004), (I-655)+(1.044)+(7.005), (I-655)+(1.044)+(7.006), (I-655)+(1.044)+(9.001), (I-655)+(1.044)+(9.002), (I-655)+(1.044)+(9.003), (I-655)+(1.044)+(9.004), (I-655)+(1.044)+(9.005), (I-655)+(1.044)+(9.006), (I-655)+(1.044)+(9.007), (I-655)+(1.044)+(9.008), (I-655)+(1.044)+(9.009), (I-655)+(1.044)+(14.001), (I-655)+(1.044)+(14.002), (I-655)+(1.044)+(15.008), (I-655)+(1.044)+(15.011), (I-655)+(1.044)+(15.012), (I-655)+(1.044)+(15.016), (I-655)+(1.044)+(15.025), (I-655)+(1.044)+(15.027), (I-655)+(1.044)+(15.047), (I-655)+(1.044)+(15.063), (I-655)+(1.044)+(15.064), (I-655)+(1.044)+(16.001), (I-655)+(1.044)+(16.002), (I-655)+(1.044)+(16.003), (I-655)+(1.044)+(16.004), (I-655)+(1.044)+(16.005), (I-655)+(1.044)+(16.006), (I-655)+(1.044)+(16.007), (I-655)+(1.044)+(16.008), (I-655)+(1.044)+(17.001), (I-655)+(1.044)+(17.002), (I-655)+(1.044)+(17.003), (I-655)+(1.044)+(17.004), (I-655)+(1.044)+(17.005), (I-655)+(1.044)+(17.006), (I-655)+(1.044)+(17.007), (I-655)+(1.044)+(17.008), (I-655)+(1.044)+(17.009), (I-655)+(1.044)+(17.010), (I-655)+(1.044)+(17.011), (I-655)+(1.044)+(17.012), (I-655)+(1.044)+(18.001),

(I-655)+(1.045)+(1.046), (I-655)+(1.045)+(1.047), (I-655)+(1.045)+(1.048), (I-655)+(1.045)+(1.049), (I-655)+(1.045)+(1.050), (I-655)+(1.045)+(1.051), (I-655)+(1.045)+(1.052), (I-655)+(1.045)+(1.053), (I-655)+(1.045)+(1.054), (I-655)+(1.045)+(1.055), (I-655)+(1.045)+(1.056), (I-655)+(1.045)+(1.057), (I-655)+(1.045)+(1.058), (I-655)+(1.045)+(1.059), (I-655)+(1.045)+(1.060), (I-655)+(1.045)+(1.061), (I-655)+(1.045)+(1.062), (I-655)+(1.045)+(1.063), (I-655)+(1.045)+(1.064), (I-655)+(1.045)+(1.065), (I-655)+(1.045)+(1.066), (I-655)+(1.045)+(1.067), (I-655)+(1.045)+(1.068), (I-655)+(1.045)+(1.069), (I-655)+(1.045)+(1.070), (I-655)+(1.045)+(1.071), (I-655)+(1.045)+(1.072), (I-655)+(1.045)+(1.073), (I-655)+(1.045)+(1.074), (I-655)+(1.045)+(1.075), (I-655)+(1.045)+(1.076), (I-655)+(1.045)+(1.077), (I-655)+(1.045)+(1.078), (I-655)+(1.045)+(1.079), (I-655)+(1.045)+(1.080), (I-655)+(1.045)+(1.081), (I-655)+(1.045)+(1.082), (I-655)+(1.045)+(1.083), (I-655)+(1.045)+(1.084), (I-655)+(1.045)+(1.085), (I-655)+(1.045)+(1.086), (I-655)+(1.045)+(1.087), (I-655)+(1.045)+(1.088), (I-655)+(1.045)+(1.089), (I-655)+(1.045)+(1.090), (I-655)+(1.045)+(1.091), (I-655)+(1.045)+(1.092), (I-655)+(1.045)+(2.001), (I-655)+(1.045)+(2.002), (I-655)+(1.045)+(2.003), (I-655)+(1.045)+(2.004), (I-655)+(1.045)+(2.005), (I-655)+(1.045)+(2.006), (I-655)+(1.045)+(2.007), (I-655)+(1.045)+(2.008), (I-655)+(1.045)+(2.009), (I-655)+(1.045)+(2.010), (I-655)+(1.045)+(2.011), (I-655)+(1.045)+(2.012), (I-655)+(1.045)+(2.013), (I-655)+(1.045)+(2.014), (I-655)+(1.045)+(2.015), (I-655)+(1.045)+(2.016), (I-655)+(1.045)+(2.017), (I-655)+(1.045)+(2.018), (I-655)+(1.045)+(2.019), (I-655)+(1.045)+(2.020), (I-655)+(1.045)+(2.021), (I-655)+(1.045)+(2.022), (I-655)+(1.045)+(2.023), (I-655)+(1.045)+(2.024), (I-655)+(1.045)+(2.025), (I-655)+(1.045)+(2.026), (I-655)+(1.045)+(2.027), (I-655)+(1.045)+(2.028), (I-655)+(1.045)+(2.029), (I-655)+(1.045)+(2.030), (I-655)+(1.045)+(2.031), (I-655)+(1.045)+(2.032), (I-655)+(1.045)+(2.033), (I-655)+(1.045)+(2.034), (I-655)+(1.045)+(2.035), (I-655)+(1.045)+(2.036), (I-655)+(1.045)+(2.037), (I-655)+(1.045)+(2.038), (I-655)+(1.045)+(2.039), (I-655)+(1.045)+(2.040), (I-655)+(1.045)+(2.041), (I-655)+(1.045)+(2.042), (I-655)+(1.045)+(2.043), (I-655)+(1.045)+(2.044), (I-655)+(1.045)+(2.045), (I-655)+(1.045)+(2.046), (I-655)+(1.045)+(2.047), (I-655)+(1.045)+(2.048), (I-655)+(1.045)+(2.049), (I-655)+(1.045)+(2.050), (I-655)+(1.045)+(2.051), (I-655)+(1.045)+(2.052), (I-655)+(1.045)+(2.053), (I-655)+(1.045)+(2.054), (I-655)+(1.045)+(2.055), (I-655)+(1.045)+(2.056), (I-655)+(1.045)+(2.057), (I-655)+(1.045)+(2.058), (I-655)+(1.045)+(2.059), (I-655)+(1.045)+(3.001), (I-655)+(1.045)+(3.002), (I-655)+(1.045)+(3.003), (I-655)+(1.045)+(3.004), (I-655)+(1.045)+(3.005), (I-655)+(1.045)+(3.006), (I-655)+(1.045)+(3.007), (I-655)+(1.045)+(3.008), (I-655)+(1.045)+(3.009), (I-655)+(1.045)+(3.010), (I-655)+(1.045)+(3.011), (I-655)+(1.045)+(3.012), (I-655)+(1.045)+(3.013), (I-655)+(1.045)+(3.014), (I-655)+(1.045)+(3.015), (I-655)+(1.045)+(3.016), (I-655)+(1.045)+(3.017), (I-655)+(1.045)+(3.018), (I-655)+(1.045)+(3.019), (I-655)+(1.045)+(3.020), (I-655)+(1.045)+(3.021), (I-655)+(1.045)+(3.022), (I-655)+(1.045)+(3.023), (I-655)+(1.045)+(3.024), (I-655)+(1.045)+(3.025), (I-655)+(1.045)+(3.026), (I-655)+(1.045)+(3.027), (I-655)+(1.045)+(3.028), (I-655)+(1.045)+(3.029), (I-655)+(1.045)+(3.030), (I-655)+(1.045)+(3.031), (I-655)+(1.045)+(5.001), (I-655)+(1.045)+(5.002), (I-655)+(1.045)+(5.003), (I-655)+(1.045)+(5.004), (I-655)+(1.045)+(5.005), (I-655)+(1.045)+(5.006), (I-655)+(1.045)+(5.007), (I-655)+(1.045)+(5.008), (I-655)+(1.045)+(5.009), (I-655)+(1.045)+(5.010), (I-655)+(1.045)+(5.011), (I-655)+(1.045)+(5.012), (I-655)+(1.045)+(5.013), (I-655)+(1.045)+(5.014), (I-655)+(1.045)+(5.015), (I-655)+(1.045)+(5.016), (I-655)+(1.045)+(5.017), (I-655)+(1.045)+(5.018), (I-655)+(1.045)+(5.019), (I-655)+(1.045)+(5.020), (I-655)+(1.045)+(5.021), (I-655)+(1.045)+(5.022), (I-655)+(1.045)+(5.023), (I-655)+(1.045)+(6.001), (I-655)+(1.045)+(6.002), (I-655)+(1.045)+(6.003), (I-655)+(1.045)+(6.004), (I-655)+(1.045)+(7.001), (I-655)+(1.045)+(7.002), (I-655)+(1.045)+(7.003), (I-655)+(1.045)+(7.004), (I-655)+(1.045)+(7.005), (I-655)+(1.045)+(7.006), (I-655)+(1.045)+(9.001), (I-655)+(1.045)+(9.002), (I-655)+(1.045)+(9.003), (I-655)+(1.045)+(9.004), (I-655)+(1.045)+(9.005), (I-655)+(1.045)+(9.006), (I-655)+(1.045)+(9.007), (I-655)+(1.045)+(9.008), (I-655)+(1.045)+(9.009), (I-655)+(1.045)+(14.001), (I-655)+(1.045)+(14.002), (I-655)+(1.045)+(15.008), (I-655)+(1.045)+(15.011), (I-655)+(1.045)+(15.012), (I-655)+(1.045)+(15.016), (I-655)+(1.045)+(15.025), (I-655)+(1.045)+(15.027), (I-655)+(1.045)+(15.047), (I-655)+(1.045)+(15.063), (I-655)+(1.045)+(15.064), (I-655)+(1.045)+(16.001), (I-655)+(1.045)+(16.002), (I-655)+(1.045)+(16.003), (I-655)+(1.045)+(16.004), (I-655)+(1.045)+(16.005), (I-655)+(1.045)+(16.006), (I-655)+(1.045)+(16.007), (I-655)+(1.045)+(16.008), (I-655)+(1.045)+(17.001), (I-655)+(1.045)+(17.002), (I-655)+(1.045)+(17.003), (I-655)+(1.045)+(17.004), (I-655)+(1.045)+(17.005), (I-655)+(1.045)+(17.006), (I-655)+(1.045)+(17.007), (I-655)+(1.045)+(17.008), (I-655)+(1.045)+(17.009), (I-655)+(1.045)+(17.010), (I-655)+(1.045)+(17.011), (I-655)+(1.045)+(17.012), (I-655)+(1.045)+(18.001),

(I-655)+(1.046)+(1.047), (I-655)+(1.046)+(1.048), (I-655)+(1.046)+(1.049), (I-655)+(1.046)+(1.050), (I-655)+(1.046)+(1.051), (I-655)+(1.046)+(1.052), (I-655)+(1.046)+(1.053), (I-655)+(1.046)+(1.054), (I-655)+(1.046)+(1.055), (I-655)+(1.046)+(1.056), (I-655)+(1.046)+(1.057), (I-655)+(1.046)+(1.058), (I-655)+(1.046)+(1.059), (I-655)+(1.046)+(1.060), (I-655)+(1.046)+(1.061), (I-655)+(1.046)+(1.062), (I-655)+(1.046)+(1.063), (I-655)+(1.046)+(1.064), (I-655)+(1.046)+(1.065), (I-655)+(1.046)+(1.066), (I-655)+(1.046)+(1.067), (I-655)+(1.046)+(1.068), (I-655)+(1.046)+(1.069), (I-655)+(1.046)+(1.070), (I-655)+(1.046)+(1.071), (I-655)+(1.046)+(1.072), (I-655)+(1.046)+(1.073), (I-655)+(1.046)+(1.074), (I-655)+(1.046)+(1.075), (I-655)+(1.046)+(1.076), (I-655)+(1.046)+(1.077), (I-655)+(1.046)+(1.078), (I-655)+(1.046)+(1.079), (I-655)+(1.046)+(1.080), (I-655)+(1.046)+(1.081), (I-655)+(1.046)+(1.082), (I-655)+(1.046)+(1.083), (I-655)+(1.046)+(1.084), (I-655)+(1.046)+(1.085), (I-655)+(1.046)+(1.086), (I-655)+(1.046)+(1.087), (I-655)+(1.046)+(1.088), (I-655)+(1.046)+(1.089), (I-655)+(1.046)+(1.090), (I-655)+(1.046)+(1.091), (I-655)+(1.046)+(1.092), (I-655)+(1.046)+(2.001), (I-655)+(1.046)+(2.002), (I-655)+(1.046)+(2.003), (I-655)+(1.046)+(2.004), (I-655)+(1.046)+(2.005), (I-655)+(1.046)+(2.006), (I-655)+(1.046)+(2.007), (I-655)+(1.046)+(2.008), (I-655)+(1.046)+(2.009), (I-655)+(1.046)+(2.010), (I-655)+(1.046)+(2.011), (I-655)+(1.046)+(2.012), (I-655)+(1.046)+(2.013), (I-655)+(1.046)+(2.014), (I-655)+(1.046)+(2.015), (I-655)+(1.046)+(2.016), (I-655)+(1.046)+(2.017), (I-655)+(1.046)+(2.018), (I-655)+(1.046)+(2.019), (I-655)+(1.046)+(2.020), (I-655)+(1.046)+(2.021), (I-655)+(1.046)+(2.022), (I-655)+(1.046)+(2.023), (I-655)+(1.046)+(2.024), (I-655)+(1.046)+(2.025), (I-655)+(1.046)+(2.026), (I-655)+(1.046)+(2.027), (I-655)+(1.046)+(2.028), (I-655)+(1.046)+(2.029), (I-655)+(1.046)+(2.030), (I-655)+(1.046)+(2.031), (I-655)+(1.046)+(2.032), (I-655)+(1.046)+(2.033), (I-655)+(1.046)+(2.034), (I-655)+(1.046)+(2.035), (I-655)+(1.046)+(2.036), (I-655)+(1.046)+(2.037), (I-655)+(1.046)+(2.038), (I-655)+(1.046)+(2.039), (I-655)+(1.046)+(2.040), (I-655)+(1.046)+(2.041), (I-655)+(1.046)+(2.042), (I-655)+(1.046)+(2.043), (I-655)+(1.046)+(2.044), (I-655)+(1.046)+(2.045), (I-655)+(1.046)+(2.046), (I-655)+(1.046)+(2.047), (I-655)+(1.046)+(2.048), (I-655)+(1.046)+(2.049), (I-655)+(1.046)+(2.050), (I-655)+(1.046)+(2.051), (I-655)+(1.046)+(2.052), (I-655)+(1.046)+(2.053), (I-655)+(1.046)+(2.054), (I-655)+(1.046)+(2.055), (I-655)+(1.046)+(2.056), (I-655)+(1.046)+(2.057), (I-655)+(1.046)+(2.058), (I-655)+(1.046)+(2.059), (I-655)+(1.046)+(3.001), (I-655)+(1.046)+(3.002), (I-655)+(1.046)+(3.003), (I-655)+(1.046)+(3.004), (I-655)+(1.046)+(3.005), (I-655)+(1.046)+(3.006), (I-655)+(1.046)+(3.007), (I-655)+(1.046)+(3.008), (I-655)+(1.046)+(3.009), (I-655)+(1.046)+(3.010), (I-655)+(1.046)+(3.011), (I-655)+(1.046)+(3.012), (I-655)+(1.046)+(3.013), (I-655)+(1.046)+(3.014), (I-655)+(1.046)+(3.015), (I-655)+(1.046)+(3.016), (I-655)+(1.046)+(3.017), (I-655)+(1.046)+(3.018), (I-655)+(1.046)+(3.019), (I-655)+(1.046)+(3.020), (I-655)+(1.046)+(3.021), (I-655)+(1.046)+(3.022), (I-655)+(1.046)+(3.023), (I-655)+(1.046)+(3.024), (I-655)+(1.046)+(3.025), (I-655)+(1.046)+(3.026), (I-655)+(1.046)+(3.027), (I-655)+(1.046)+(3.028), (I-655)+(1.046)+(3.029), (I-655)+(1.046)+(3.030), (I-655)+(1.046)+(3.031), (I-655)+(1.046)+(5.001), (I-655)+(1.046)+(5.002), (I-655)+(1.046)+(5.003), (I-655)+(1.046)+(5.004), (I-655)+(1.046)+(5.005), (I-655)+(1.046)+(5.006), (I-655)+(1.046)+(5.007), (I-655)+(1.046)+(5.008), (I-655)+(1.046)+(5.009), (I-655)+(1.046)+(5.010), (I-655)+(1.046)+(5.011), (I-655)+(1.046)+(5.012), (I-655)+(1.046)+(5.013), (I-655)+(1.046)+(5.014), (I-655)+(1.046)+(5.015), (I-655)+(1.046)+(5.016), (I-655)+(1.046)+(5.017), (I-655)+(1.046)+(5.018), (I-655)+(1.046)+(5.019), (I-655)+(1.046)+(5.020), (I-655)+(1.046)+(5.021), (I-655)+(1.046)+(5.022), (I-655)+(1.046)+(5.023), (I-655)+(1.046)+(6.001), (I-655)+(1.046)+(6.002), (I-655)+(1.046)+(6.003), (I-655)+(1.046)+(6.004), (I-655)+(1.046)+(7.001), (I-655)+(1.046)+(7.002), (I-655)+(1.046)+(7.003), (I-655)+(1.046)+(7.004), (I-655)+(1.046)+(7.005), (I-655)+(1.046)+(7.006), (I-655)+(1.046)+(9.001), (I-655)+(1.046)+(9.002), (I-655)+(1.046)+(9.003), (I-655)+(1.046)+(9.004), (I-655)+(1.046)+(9.005), (I-655)+(1.046)+(9.006), (I-655)+(1.046)+(9.007), (I-655)+(1.046)+(9.008), (I-655)+(1.046)+(9.009), (I-655)+(1.046)+(14.001), (I-655)+(1.046)+(14.002), (I-655)+(1.046)+(15.008), (I-655)+(1.046)+(15.011), (I-655)+(1.046)+(15.012), (I-655)+(1.046)+(15.016), (I-655)+(1.046)+(15.025), (I-655)+(1.046)+(15.027), (I-655)+(1.046)+(15.047), (I-655)+(1.046)+(15.063), (I-655)+(1.046)+(15.064), (I-655)+(1.046)+(16.001), (I-655)+(1.046)+(16.002), (I-655)+(1.046)+(16.003), (I-655)+(1.046)+(16.004), (I-655)+(1.046)+(16.005), (I-655)+(1.046)+(16.006), (I-655)+(1.046)+(16.007), (I-655)+(1.046)+(16.008), (I-655)+(1.046)+(17.001), (I-655)+(1.046)+(17.002), (I-655)+(1.046)+(17.003), (I-655)+(1.046)+(17.004), (I-655)+(1.046)+(17.005), (I-655)+(1.046)+(17.006), (I-655)+(1.046)+(17.007), (I-655)+(1.046)+(17.008), (I-655)+(1.046)+(17.009), (I-655)+(1.046)+(17.010), (I-655)+(1.046)+(17.011), (I-655)+(1.046)+(17.012), (I-655)+(1.046)+(18.001),

(I-655)+(1.047)+(1.048), (I-655)+(1.047)+(1.049), (I-655)+(1.047)+(1.050), (I-655)+(1.047)+(1.051), (I-655)+(1.047)+(1.052), (I-655)+(1.047)+(1.053), (I-655)+(1.047)+(1.054), (I-655)+(1.047)+(1.055), (I-655)+(1.047)+(1.056), (I-655)+(1.047)+(1.057), (I-655)+(1.047)+(1.058), (I-655)+(1.047)+(1.059), (I-655)+(1.047)+(1.060), (I-655)+(1.047)+(1.061), (I-655)+(1.047)+(1.062), (I-655)+(1.047)+(1.063), (I-655)+(1.047)+(1.064), (I-655)+(1.047)+(1.065), (I-655)+(1.047)+(1.066), (I-655)+(1.047)+(1.067), (I-655)+(1.047)+(1.068), (I-655)+(1.047)+(1.069), (I-655)+(1.047)+(1.070), (I-655)+(1.047)+(1.071), (I-655)+(1.047)+(1.072), (I-655)+(1.047)+(1.073), (I-655)+(1.047)+(1.074), (I-655)+(1.047)+(1.075), (I-655)+(1.047)+(1.076), (I-655)+(1.047)+(1.077), (I-655)+(1.047)+(1.078), (I-655)+(1.047)+(1.079), (I-655)+(1.047)+(1.080), (I-655)+(1.047)+(1.081), (I-655)+(1.047)+(1.082), (I-655)+(1.047)+(1.083), (I-655)+(1.047)+(1.084), (I-655)+(1.047)+(1.085), (I-655)+(1.047)+(1.086), (I-655)+(1.047)+(1.087), (I-655)+(1.047)+(1.088), (I-655)+(1.047)+(1.089), (I-655)+(1.047)+(1.090), (I-655)+(1.047)+(1.091), (I-655)+(1.047)+(1.092), (I-655)+(1.047)+(2.001), (I-655)+(1.047)+(2.002), (I-655)+(1.047)+(2.003), (I-655)+(1.047)+(2.004), (I-655)+(1.047)+(2.005), (I-655)+(1.047)+(2.006), (I-655)+(1.047)+(2.007), (I-655)+(1.047)+(2.008), (I-655)+(1.047)+(2.009), (I-655)+(1.047)+(2.010), (I-655)+(1.047)+(2.011), (I-655)+(1.047)+(2.012), (I-655)+(1.047)+(2.013), (I-655)+(1.047)+(2.014), (I-655)+(1.047)+(2.015), (I-655)+(1.047)+(2.016), (I-655)+(1.047)+(2.017), (I-655)+(1.047)+(2.018), (I-655)+(1.047)+(2.019), (I-655)+(1.047)+(2.020), (I-655)+(1.047)+(2.021), (I-655)+(1.047)+(2.022), (I-655)+(1.047)+(2.023), (I-655)+(1.047)+(2.024), (I-655)+(1.047)+(2.025), (I-655)+(1.047)+(2.026), (I-655)+(1.047)+(2.027), (I-655)+(1.047)+(2.028), (I-655)+(1.047)+(2.029), (I-655)+(1.047)+(2.030), (I-655)+(1.047)+(2.031), (I-655)+(1.047)+(2.032), (I-655)+(1.047)+(2.033), (I-655)+(1.047)+(2.034), (I-655)+(1.047)+(2.035), (I-655)+(1.047)+(2.036), (I-655)+(1.047)+(2.037), (I-655)+(1.047)+(2.038), (I-655)+(1.047)+(2.039), (I-655)+(1.047)+(2.040), (I-655)+(1.047)+(2.041), (I-655)+(1.047)+(2.042), (I-655)+(1.047)+(2.043), (I-655)+(1.047)+(2.044), (I-655)+(1.047)+(2.045), (I-655)+(1.047)+(2.046), (I-655)+(1.047)+(2.047), (I-655)+(1.047)+(2.048), (I-655)+(1.047)+(2.049), (I-655)+(1.047)+(2.050), (I-655)+(1.047)+(2.051), (I-655)+(1.047)+(2.052), (I-655)+(1.047)+(2.053), (I-655)+(1.047)+(2.054), (I-655)+(1.047)+(2.055), (I-655)+(1.047)+(2.056), (I-655)+(1.047)+(2.057), (I-655)+(1.047)+(2.058), (I-655)+(1.047)+(2.059), (I-655)+(1.047)+(3.001), (I-655)+(1.047)+(3.002), (I-655)+(1.047)+(3.003), (I-655)+(1.047)+(3.004), (I-655)+(1.047)+(3.005), (I-655)+(1.047)+(3.006), (I-655)+(1.047)+(3.007), (I-655)+(1.047)+(3.008), (I-655)+(1.047)+(3.009), (I-655)+(1.047)+(3.010), (I-655)+(1.047)+(3.011), (I-655)+(1.047)+(3.012), (I-655)+(1.047)+(3.013), (I-655)+(1.047)+(3.014), (I-655)+(1.047)+(3.015), (I-655)+(1.047)+(3.016), (I-655)+(1.047)+(3.017), (I-655)+(1.047)+(3.018), (I-655)+(1.047)+(3.019), (I-655)+(1.047)+(3.020), (I-655)+(1.047)+(3.021), (I-655)+(1.047)+(3.022), (I-655)+(1.047)+(3.023), (I-655)+(1.047)+(3.024), (I-655)+(1.047)+(3.025), (I-655)+(1.047)+(3.026), (I-655)+(1.047)+(3.027), (I-655)+(1.047)+(3.028), (I-655)+(1.047)+(3.029), (I-655)+(1.047)+(3.030), (I-655)+(1.047)+(3.031), (I-655)+(1.047)+(5.001), (I-655)+(1.047)+(5.002), (I-655)+(1.047)+(5.003), (I-655)+(1.047)+(5.004), (I-655)+(1.047)+(5.005), (I-655)+(1.047)+(5.006), (I-655)+(1.047)+(5.007), (I-655)+(1.047)+(5.008), (I-655)+(1.047)+(5.009), (I-655)+(1.047)+(5.010), (I-655)+(1.047)+(5.011), (I-655)+(1.047)+(5.012), (I-655)+(1.047)+(5.013), (I-655)+(1.047)+(5.014), (I-655)+(1.047)+(5.015), (I-655)+(1.047)+(5.016), (I-655)+(1.047)+(5.017), (I-655)+(1.047)+(5.018), (I-655)+(1.047)+(5.019), (I-655)+(1.047)+(5.020), (I-655)+(1.047)+(5.021), (I-655)+(1.047)+(5.022), (I-655)+(1.047)+(5.023), (I-655)+(1.047)+(6.001), (I-655)+(1.047)+(6.002), (I-655)+(1.047)+(6.003), (I-655)+(1.047)+(6.004), (I-655)+(1.047)+(7.001), (I-655)+(1.047)+(7.002), (I-655)+(1.047)+(7.003), (I-655)+(1.047)+(7.004), (I-655)+(1.047)+(7.005), (I-655)+(1.047)+(7.006), (I-655)+(1.047)+(9.001), (I-655)+(1.047)+(9.002), (I-655)+(1.047)+(9.003), (I-655)+(1.047)+(9.004), (I-655)+(1.047)+(9.005), (I-655)+(1.047)+(9.006), (I-655)+(1.047)+(9.007), (I-655)+(1.047)+(9.008), (I-655)+(1.047)+(9.009), (I-655)+(1.047)+(14.001), (I-655)+(1.047)+(14.002), (I-655)+(1.047)+(15.008), (I-655)+(1.047)+(15.011), (I-655)+(1.047)+(15.012), (I-655)+(1.047)+(15.016), (I-655)+(1.047)+(15.025), (I-655)+(1.047)+(15.027), (I-655)+(1.047)+(15.047), (I-655)+(1.047)+(15.063), (I-655)+(1.047)+(15.064), (I-655)+(1.047)+(16.001), (I-655)+(1.047)+(16.002), (I-655)+(1.047)+(16.003), (I-655)+(1.047)+(16.004), (I-655)+(1.047)+(16.005), (I-655)+(1.047)+(16.006), (I-655)+(1.047)+(16.007), (I-655)+(1.047)+(16.008), (I-655)+(1.047)+(17.001), (I-655)+(1.047)+(17.002), (I-655)+(1.047)+(17.003), (I-655)+(1.047)+(17.004), (I-655)+(1.047)+(17.005), (I-655)+(1.047)+(17.006), (I-655)+(1.047)+(17.007), (I-655)+(1.047)+(17.008), (I-655)+(1.047)+(17.009), (I-655)+(1.047)+(17.010), (I-655)+(1.047)+(17.011), (I-655)+(1.047)+(17.012), (I-655)+(1.047)+(18.001),

(I-655)+(1.048)+(1.049), (I-655)+(1.048)+(1.050), (I-655)+(1.048)+(1.051), (I-655)+(1.048)+(1.052), (I-655)+(1.048)+(1.053), (I-655)+(1.048)+(1.054), (I-655)+(1.048)+(1.055), (I-655)+(1.048)+(1.056), (I-655)+(1.048)+(1.057), (I-655)+(1.048)+(1.058), (I-655)+(1.048)+(1.059), (I-655)+(1.048)+(1.060), (I-655)+(1.048)+(1.061), (I-655)+(1.048)+(1.062), (I-655)+(1.048)+(1.063), (I-655)+(1.048)+(1.064), (I-655)+(1.048)+(1.065), (I-655)+(1.048)+(1.066), (I-655)+(1.048)+(1.067), (I-655)+(1.048)+(1.068), (I-655)+(1.048)+(1.069), (I-655)+(1.048)+(1.070), (I-655)+(1.048)+(1.071), (I-655)+(1.048)+(1.072), (I-655)+(1.048)+(1.073), (I-655)+(1.048)+(1.074), (I-655)+(1.048)+(1.075), (I-655)+(1.048)+(1.076), (I-655)+(1.048)+(1.077), (I-655)+(1.048)+(1.078), (I-655)+(1.048)+(1.079), (I-655)+(1.048)+(1.080), (I-655)+(1.048)+(1.081), (I-655)+(1.048)+(1.082), (I-655)+(1.048)+(1.083), (I-655)+(1.048)+(1.084), (I-655)+(1.048)+(1.085), (I-655)+(1.048)+(1.086), (I-655)+(1.048)+(1.087), (I-655)+(1.048)+(1.088), (I-655)+(1.048)+(1.089), (I-655)+(1.048)+(1.090), (I-655)+(1.048)+(1.091), (I-655)+(1.048)+(1.092), (I-655)+(1.048)+(2.001), (I-655)+(1.048)+(2.002), (I-655)+(1.048)+(2.003), (I-655)+(1.048)+(2.004), (I-655)+(1.048)+(2.005), (I-655)+(1.048)+(2.006), (I-655)+(1.048)+(2.007), (I-655)+(1.048)+(2.008), (I-655)+(1.048)+(2.009), (I-655)+(1.048)+(2.010), (I-655)+(1.048)+(2.011), (I-655)+(1.048)+(2.012), (I-655)+(1.048)+(2.013), (I-655)+(1.048)+(2.014), (I-655)+(1.048)+(2.015), (I-655)+(1.048)+(2.016), (I-655)+(1.048)+(2.017), (I-655)+(1.048)+(2.018), (I-655)+(1.048)+(2.019), (I-655)+(1.048)+(2.020), (I-655)+(1.048)+(2.021), (I-655)+(1.048)+(2.022), (I-655)+(1.048)+(2.023), (I-655)+(1.048)+(2.024), (I-655)+(1.048)+(2.025), (I-655)+(1.048)+(2.026), (I-655)+(1.048)+(2.027), (I-655)+(1.048)+(2.028), (I-655)+(1.048)+(2.029), (I-655)+(1.048)+(2.030), (I-655)+(1.048)+(2.031), (I-655)+(1.048)+(2.032), (I-655)+(1.048)+(2.033), (I-655)+(1.048)+(2.034), (I-655)+(1.048)+(2.035), (I-655)+(1.048)+(2.036), (I-655)+(1.048)+(2.037), (I-655)+(1.048)+(2.038), (I-655)+(1.048)+(2.039), (I-655)+(1.048)+(2.040), (I-655)+(1.048)+(2.041), (I-655)+(1.048)+(2.042), (I-655)+(1.048)+(2.043), (I-655)+(1.048)+(2.044), (I-655)+(1.048)+(2.045), (I-655)+(1.048)+(2.046), (I-655)+(1.048)+(2.047), (I-655)+(1.048)+(2.048), (I-655)+(1.048)+(2.049), (I-655)+(1.048)+(2.050), (I-655)+(1.048)+(2.051), (I-655)+(1.048)+(2.052), (I-655)+(1.048)+(2.053), (I-655)+(1.048)+(2.054), (I-655)+(1.048)+(2.055), (I-655)+(1.048)+(2.056), (I-655)+(1.048)+(2.057), (I-655)+(1.048)+(2.058), (I-655)+(1.048)+(2.059), (I-655)+(1.048)+(3.001), (I-655)+(1.048)+(3.002), (I-655)+(1.048)+(3.003), (I-655)+(1.048)+(3.004), (I-655)+(1.048)+(3.005), (I-655)+(1.048)+(3.006), (I-655)+(1.048)+(3.007), (I-655)+(1.048)+(3.008), (I-655)+(1.048)+(3.009), (I-655)+(1.048)+(3.010), (I-655)+(1.048)+(3.011), (I-655)+(1.048)+(3.012), (I-655)+(1.048)+(3.013), (I-655)+(1.048)+(3.014), (I-655)+(1.048)+(3.015), (I-655)+(1.048)+(3.016), (I-655)+(1.048)+(3.017), (I-655)+(1.048)+(3.018), (I-655)+(1.048)+(3.019), (I-655)+(1.048)+(3.020), (I-655)+(1.048)+(3.021), (I-655)+(1.048)+(3.022), (I-655)+(1.048)+(3.023), (I-655)+(1.048)+(3.024), (I-655)+(1.048)+(3.025), (I-655)+(1.048)+(3.026), (I-655)+(1.048)+(3.027), (I-655)+(1.048)+(3.028), (I-655)+(1.048)+(3.029), (I-655)+(1.048)+(3.030), (I-655)+(1.048)+(3.031), (I-655)+(1.048)+(5.001), (I-655)+(1.048)+(5.002), (I-655)+(1.048)+(5.003), (I-655)+(1.048)+(5.004), (I-655)+(1.048)+(5.005), (I-655)+(1.048)+(5.006), (I-655)+(1.048)+(5.007), (I-655)+(1.048)+(5.008), (I-655)+(1.048)+(5.009), (I-655)+(1.048)+(5.010), (I-655)+(1.048)+(5.011), (I-655)+(1.048)+(5.012), (I-655)+(1.048)+(5.013), (I-655)+(1.048)+(5.014), (I-655)+(1.048)+(5.015), (I-655)+(1.048)+(5.016), (I-655)+(1.048)+(5.017), (I-655)+(1.048)+(5.018), (I-655)+(1.048)+(5.019), (I-655)+(1.048)+(5.020), (I-655)+(1.048)+(5.021), (I-655)+(1.048)+(5.022), (I-655)+(1.048)+(5.023), (I-655)+(1.048)+(6.001), (I-655)+(1.048)+(6.002), (I-655)+(1.048)+(6.003), (I-655)+(1.048)+(6.004), (I-655)+(1.048)+(7.001), (I-655)+(1.048)+(7.002), (I-655)+(1.048)+(7.003), (I-655)+(1.048)+(7.004), (I-655)+(1.048)+(7.005), (I-655)+(1.048)+(7.006), (I-655)+(1.048)+(9.001), (I-655)+(1.048)+(9.002), (I-655)+(1.048)+(9.003), (I-655)+(1.048)+(9.004), (I-655)+(1.048)+(9.005), (I-655)+(1.048)+(9.006), (I-655)+(1.048)+(9.007), (I-655)+(1.048)+(9.008), (I-655)+(1.048)+(9.009), (I-655)+(1.048)+(14.001), (I-655)+(1.048)+(14.002), (I-655)+(1.048)+(15.008), (I-655)+(1.048)+(15.011), (I-655)+(1.048)+(15.012), (I-655)+(1.048)+(15.016), (I-655)+(1.048)+(15.025), (I-655)+(1.048)+(15.027), (I-655)+(1.048)+(15.047), (I-655)+(1.048)+(15.063), (I-655)+(1.048)+(15.064), (I-655)+(1.048)+(16.001), (I-655)+(1.048)+(16.002), (I-655)+(1.048)+(16.003), (I-655)+(1.048)+(16.004), (I-655)+(1.048)+(16.005), (I-655)+(1.048)+(16.006), (I-655)+(1.048)+(16.007), (I-655)+(1.048)+(16.008), (I-655)+(1.048)+(17.001), (I-655)+(1.048)+(17.002), (I-655)+(1.048)+(17.003), (I-655)+(1.048)+(17.004), (I-655)+(1.048)+(17.005), (I-655)+(1.048)+(17.006), (I-655)+(1.048)+(17.007), (I-655)+(1.048)+(17.008), (I-655)+(1.048)+(17.009), (I-655)+(1.048)+(17.010), (I-655)+(1.048)+(17.011), (I-655)+(1.048)+(17.012), (I-655)+(1.048)+(18.001),

(I-655)+(1.049)+(1.050), (I-655)+(1.049)+(1.051), (I-655)+(1.049)+(1.052), (I-655)+(1.049)+(1.053), (I-655)+(1.049)+(1.054), (I-655)+(1.049)+(1.055), (I-655)+(1.049)+(1.056), (I-655)+(1.049)+(1.057), (I-655)+(1.049)+(1.058), (I-655)+(1.049)+(1.059), (I-655)+(1.049)+(1.060), (I-655)+(1.049)+(1.061), (I-655)+(1.049)+(1.062), (I-655)+(1.049)+(1.063), (I-655)+(1.049)+(1.064), (I-655)+(1.049)+(1.065), (I-655)+(1.049)+(1.066), (I-655)+(1.049)+(1.067), (I-655)+(1.049)+(1.068), (I-655)+(1.049)+(1.069), (I-655)+(1.049)+(1.070), (I-655)+(1.049)+(1.071), (I-655)+(1.049)+(1.072), (I-655)+(1.049)+(1.073), (I-655)+(1.049)+(1.074), (I-655)+(1.049)+(1.075), (I-655)+(1.049)+(1.076), (I-655)+(1.049)+(1.077), (I-655)+(1.049)+(1.078), (I-655)+(1.049)+(1.079), (I-655)+(1.049)+(1.080), (I-655)+(1.049)+(1.081), (I-655)+(1.049)+(1.082), (I-655)+(1.049)+(1.083), (I-655)+(1.049)+(1.084), (I-655)+(1.049)+(1.085), (I-655)+(1.049)+(1.086), (I-655)+(1.049)+(1.087), (I-655)+(1.049)+(1.088), (I-655)+(1.049)+(1.089), (I-655)+(1.049)+(1.090), (I-655)+(1.049)+(1.091), (I-655)+(1.049)+(1.092), (I-655)+(1.049)+(2.001), (I-655)+(1.049)+(2.002), (I-655)+(1.049)+(2.003), (I-655)+(1.049)+(2.004), (I-655)+(1.049)+(2.005), (I-655)+(1.049)+(2.006), (I-655)+(1.049)+(2.007), (I-655)+(1.049)+(2.008), (I-655)+(1.049)+(2.009), (I-655)+(1.049)+(2.010), (I-655)+(1.049)+(2.011), (I-655)+(1.049)+(2.012), (I-655)+(1.049)+(2.013), (I-655)+(1.049)+(2.014), (I-655)+(1.049)+(2.015), (I-655)+(1.049)+(2.016), (I-655)+(1.049)+(2.017), (I-655)+(1.049)+(2.018), (I-655)+(1.049)+(2.019), (I-655)+(1.049)+(2.020), (I-655)+(1.049)+(2.021), (I-655)+(1.049)+(2.022), (I-655)+(1.049)+(2.023), (I-655)+(1.049)+(2.024), (I-655)+(1.049)+(2.025), (I-655)+(1.049)+(2.026), (I-655)+(1.049)+(2.027), (I-655)+(1.049)+(2.028), (I-655)+(1.049)+(2.029), (I-655)+(1.049)+(2.030), (I-655)+(1.049)+(2.031), (I-655)+(1.049)+(2.032), (I-655)+(1.049)+(2.033), (I-655)+(1.049)+(2.034), (I-655)+(1.049)+(2.035), (I-655)+(1.049)+(2.036), (I-655)+(1.049)+(2.037), (I-655)+(1.049)+(2.038), (I-655)+(1.049)+(2.039), (I-655)+(1.049)+(2.040), (I-655)+(1.049)+(2.041), (I-655)+(1.049)+(2.042), (I-655)+(1.049)+(2.043), (I-655)+(1.049)+(2.044), (I-655)+(1.049)+(2.045), (I-655)+(1.049)+(2.046), (I-655)+(1.049)+(2.047), (I-655)+(1.049)+(2.048), (I-655)+(1.049)+(2.049), (I-655)+(1.049)+(2.050), (I-655)+(1.049)+(2.051), (I-655)+(1.049)+(2.052), (I-655)+(1.049)+(2.053), (I-655)+(1.049)+(2.054), (I-655)+(1.049)+(2.055), (I-655)+(1.049)+(2.056), (I-655)+(1.049)+(2.057), (I-655)+(1.049)+(2.058), (I-655)+(1.049)+(2.059), (I-655)+(1.049)+(3.001), (I-655)+(1.049)+(3.002), (I-655)+(1.049)+(3.003), (I-655)+(1.049)+(3.004), (I-655)+(1.049)+(3.005), (I-655)+(1.049)+(3.006), (I-655)+(1.049)+(3.007), (I-655)+(1.049)+(3.008), (I-655)+(1.049)+(3.009), (I-655)+(1.049)+(3.010), (I-655)+(1.049)+(3.011), (I-655)+(1.049)+(3.012), (I-655)+(1.049)+(3.013), (I-655)+(1.049)+(3.014), (I-655)+(1.049)+(3.015), (I-655)+(1.049)+(3.016), (I-655)+(1.049)+(3.017), (I-655)+(1.049)+(3.018), (I-655)+(1.049)+(3.019), (I-655)+(1.049)+(3.020), (I-655)+(1.049)+(3.021), (I-655)+(1.049)+(3.022), (I-655)+(1.049)+(3.023), (I-655)+(1.049)+(3.024), (I-655)+(1.049)+(3.025), (I-655)+(1.049)+(3.026), (I-655)+(1.049)+(3.027), (I-655)+(1.049)+(3.028), (I-655)+(1.049)+(3.029), (I-655)+(1.049)+(3.030), (I-655)+(1.049)+(3.031), (I-655)+(1.049)+(5.001), (I-655)+(1.049)+(5.002), (I-655)+(1.049)+(5.003), (I-655)+(1.049)+(5.004), (I-655)+(1.049)+(5.005), (I-655)+(1.049)+(5.006), (I-655)+(1.049)+(5.007), (I-655)+(1.049)+(5.008), (I-655)+(1.049)+(5.009), (I-655)+(1.049)+(5.010), (I-655)+(1.049)+(5.011), (I-655)+(1.049)+(5.012), (I-655)+(1.049)+(5.013), (I-655)+(1.049)+(5.014), (I-655)+(1.049)+(5.015), (I-655)+(1.049)+(5.016), (I-655)+(1.049)+(5.017), (I-655)+(1.049)+(5.018), (I-655)+(1.049)+(5.019), (I-655)+(1.049)+(5.020), (I-655)+(1.049)+(5.021), (I-655)+(1.049)+(5.022), (I-655)+(1.049)+(5.023), (I-655)+(1.049)+(6.001), (I-655)+(1.049)+(6.002), (I-655)+(1.049)+(6.003), (I-655)+(1.049)+(6.004), (I-655)+(1.049)+(7.001), (I-655)+(1.049)+(7.002), (I-655)+(1.049)+(7.003), (I-655)+(1.049)+(7.004), (I-655)+(1.049)+(7.005), (I-655)+(1.049)+(7.006), (I-655)+(1.049)+(9.001), (I-655)+(1.049)+(9.002), (I-655)+(1.049)+(9.003), (I-655)+(1.049)+(9.004), (I-655)+(1.049)+(9.005), (I-655)+(1.049)+(9.006), (I-655)+(1.049)+(9.007), (I-655)+(1.049)+(9.008), (I-655)+(1.049)+(9.009), (I-655)+(1.049)+(14.001), (I-655)+(1.049)+(14.002), (I-655)+(1.049)+(15.008), (I-655)+(1.049)+(15.011), (I-655)+(1.049)+(15.012), (I-655)+(1.049)+(15.016), (I-655)+(1.049)+(15.025), (I-655)+(1.049)+(15.027), (I-655)+(1.049)+(15.047), (I-655)+(1.049)+(15.063), (I-655)+(1.049)+(15.064), (I-655)+(1.049)+(16.001), (I-655)+(1.049)+(16.002), (I-655)+(1.049)+(16.003), (I-655)+(1.049)+(16.004), (I-655)+(1.049)+(16.005), (I-655)+(1.049)+(16.006), (I-655)+(1.049)+(16.007), (I-655)+(1.049)+(16.008), (I-655)+(1.049)+(17.001), (I-655)+(1.049)+(17.002), (I-655)+(1.049)+(17.003), (I-655)+(1.049)+(17.004), (I-655)+(1.049)+(17.005), (I-655)+(1.049)+(17.006), (I-655)+(1.049)+(17.007), (I-655)+(1.049)+(17.008), (I-655)+(1.049)+(17.009), (I-655)+(1.049)+(17.010), (I-655)+(1.049)+(17.011), (I-655)+(1.049)+(17.012), (I-655)+(1.049)+(18.001),

(I-655)+(1.050)+(1.051), (I-655)+(1.050)+(1.052), (I-655)+(1.050)+(1.053), (I-655)+(1.050)+(1.054), (I-655)+(1.050)+(1.055), (I-655)+(1.050)+(1.056), (I-655)+(1.050)+(1.057), (I-655)+(1.050)+(1.058), (I-655)+(1.050)+(1.059), (I-655)+(1.050)+(1.060), (I-655)+(1.050)+(1.061), (I-655)+(1.050)+(1.062), (I-655)+(1.050)+(1.063), (I-655)+(1.050)+(1.064), (I-655)+(1.050)+(1.065), (I-655)+(1.050)+(1.066), (I-655)+(1.050)+(1.067), (I-655)+(1.050)+(1.068), (I-655)+(1.050)+(1.069), (I-655)+(1.050)+(1.070), (I-655)+(1.050)+(1.071), (I-655)+(1.050)+(1.072), (I-655)+(1.050)+(1.073), (I-655)+(1.050)+(1.074), (I-655)+(1.050)+(1.075), (I-655)+(1.050)+(1.076), (I-655)+(1.050)+(1.077), (I-655)+(1.050)+(1.078), (I-655)+(1.050)+(1.079), (I-655)+(1.050)+(1.080), (I-655)+(1.050)+(1.081), (I-655)+(1.050)+(1.082), (I-655)+(1.050)+(1.083), (I-655)+(1.050)+(1.084), (I-655)+(1.050)+(1.085), (I-655)+(1.050)+(1.086), (I-655)+(1.050)+(1.087), (I-655)+(1.050)+(1.088), (I-655)+(1.050)+(1.089), (I-655)+(1.050)+(1.090), (I-655)+(1.050)+(1.091), (I-655)+(1.050)+(1.092), (I-655)+(1.050)+(2.001), (I-655)+(1.050)+(2.002), (I-655)+(1.050)+(2.003), (I-655)+(1.050)+(2.004), (I-655)+(1.050)+(2.005), (I-655)+(1.050)+(2.006), (I-655)+(1.050)+(2.007), (I-655)+(1.050)+(2.008), (I-655)+(1.050)+(2.009), (I-655)+(1.050)+(2.010), (I-655)+(1.050)+(2.011), (I-655)+(1.050)+(2.012), (I-655)+(1.050)+(2.013), (I-655)+(1.050)+(2.014), (I-655)+(1.050)+(2.015), (I-655)+(1.050)+(2.016), (I-655)+(1.050)+(2.017), (I-655)+(1.050)+(2.018), (I-655)+(1.050)+(2.019), (I-655)+(1.050)+(2.020), (I-655)+(1.050)+(2.021), (I-655)+(1.050)+(2.022), (I-655)+(1.050)+(2.023), (I-655)+(1.050)+(2.024), (I-655)+(1.050)+(2.025), (I-655)+(1.050)+(2.026), (I-655)+(1.050)+(2.027), (I-655)+(1.050)+(2.028), (I-655)+(1.050)+(2.029), (I-655)+(1.050)+(2.030), (I-655)+(1.050)+(2.031), (I-655)+(1.050)+(2.032), (I-655)+(1.050)+(2.033), (I-655)+(1.050)+(2.034), (I-655)+(1.050)+(2.035), (I-655)+(1.050)+(2.036), (I-655)+(1.050)+(2.037), (I-655)+(1.050)+(2.038), (I-655)+(1.050)+(2.039), (I-655)+(1.050)+(2.040), (I-655)+(1.050)+(2.041), (I-655)+(1.050)+(2.042), (I-655)+(1.050)+(2.043), (I-655)+(1.050)+(2.044), (I-655)+(1.050)+(2.045), (I-655)+(1.050)+(2.046), (I-655)+(1.050)+(2.047), (I-655)+(1.050)+(2.048), (I-655)+(1.050)+(2.049), (I-655)+(1.050)+(2.050), (I-655)+(1.050)+(2.051), (I-655)+(1.050)+(2.052), (I-655)+(1.050)+(2.053), (I-655)+(1.050)+(2.054), (I-655)+(1.050)+(2.055), (I-655)+(1.050)+(2.056), (I-655)+(1.050)+(2.057), (I-655)+(1.050)+(2.058), (I-655)+(1.050)+(2.059), (I-655)+(1.050)+(3.001), (I-655)+(1.050)+(3.002), (I-655)+(1.050)+(3.003), (I-655)+(1.050)+(3.004), (I-655)+(1.050)+(3.005), (I-655)+(1.050)+(3.006), (I-655)+(1.050)+(3.007), (I-655)+(1.050)+(3.008), (I-655)+(1.050)+(3.009), (I-655)+(1.050)+(3.010), (I-655)+(1.050)+(3.011), (I-655)+(1.050)+(3.012), (I-655)+(1.050)+(3.013), (I-655)+(1.050)+(3.014), (I-655)+(1.050)+(3.015), (I-655)+(1.050)+(3.016), (I-655)+(1.050)+(3.017), (I-655)+(1.050)+(3.018), (I-655)+(1.050)+(3.019), (I-655)+(1.050)+(3.020), (I-655)+(1.050)+(3.021), (I-655)+(1.050)+(3.022), (I-655)+(1.050)+(3.023), (I-655)+(1.050)+(3.024), (I-655)+(1.050)+(3.025), (I-655)+(1.050)+(3.026), (I-655)+(1.050)+(3.027), (I-655)+(1.050)+(3.028), (I-655)+(1.050)+(3.029), (I-655)+(1.050)+(3.030), (I-655)+(1.050)+(3.031), (I-655)+(1.050)+(5.001), (I-655)+(1.050)+(5.002), (I-655)+(1.050)+(5.003), (I-655)+(1.050)+(5.004), (I-655)+(1.050)+(5.005), (I-655)+(1.050)+(5.006), (I-655)+(1.050)+(5.007), (I-655)+(1.050)+(5.008), (I-655)+(1.050)+(5.009), (I-655)+(1.050)+(5.010), (I-655)+(1.050)+(5.011), (I-655)+(1.050)+(5.012), (I-655)+(1.050)+(5.013), (I-655)+(1.050)+(5.014), (I-655)+(1.050)+(5.015), (I-655)+(1.050)+(5.016), (I-655)+(1.050)+(5.017), (I-655)+(1.050)+(5.018), (I-655)+(1.050)+(5.019), (I-655)+(1.050)+(5.020), (I-655)+(1.050)+(5.021), (I-655)+(1.050)+(5.022), (I-655)+(1.050)+(5.023), (I-655)+(1.050)+(6.001), (I-655)+(1.050)+(6.002), (I-655)+(1.050)+(6.003), (I-655)+(1.050)+(6.004), (I-655)+(1.050)+(7.001), (I-655)+(1.050)+(7.002), (I-655)+(1.050)+(7.003), (I-655)+(1.050)+(7.004), (I-655)+(1.050)+(7.005), (I-655)+(1.050)+(7.006), (I-655)+(1.050)+(9.001), (I-655)+(1.050)+(9.002), (I-655)+(1.050)+(9.003), (I-655)+(1.050)+(9.004), (I-655)+(1.050)+(9.005), (I-655)+(1.050)+(9.006), (I-655)+(1.050)+(9.007), (I-655)+(1.050)+(9.008), (I-655)+(1.050)+(9.009), (I-655)+(1.050)+(14.001), (I-655)+(1.050)+(14.002), (I-655)+(1.050)+(15.008), (I-655)+(1.050)+(15.011), (I-655)+(1.050)+(15.012), (I-655)+(1.050)+(15.016), (I-655)+(1.050)+(15.025), (I-655)+(1.050)+(15.027), (I-655)+(1.050)+(15.047), (I-655)+(1.050)+(15.063), (I-655)+(1.050)+(15.064), (I-655)+(1.050)+(16.001), (I-655)+(1.050)+(16.002), (I-655)+(1.050)+(16.003), (I-655)+(1.050)+(16.004), (I-655)+(1.050)+(16.005), (I-655)+(1.050)+(16.006), (I-655)+(1.050)+(16.007), (I-655)+(1.050)+(16.008), (I-655)+(1.050)+(17.001), (I-655)+(1.050)+(17.002), (I-655)+(1.050)+(17.003), (I-655)+(1.050)+(17.004), (I-655)+(1.050)+(17.005), (I-655)+(1.050)+(17.006), (I-655)+(1.050)+(17.007), (I-655)+(1.050)+(17.008), (I-655)+(1.050)+(17.009), (I-655)+(1.050)+(17.010), (I-655)+(1.050)+(17.011), (I-655)+(1.050)+(17.012), (I-655)+(1.050)+(18.001),

(I-655)+(1.051)+(1.052), (I-655)+(1.051)+(1.053), (I-655)+(1.051)+(1.054), (I-655)+(1.051)+(1.055), (I-655)+(1.051)+(1.056), (I-655)+(1.051)+(1.057), (I-655)+(1.051)+(1.058), (I-655)+(1.051)+(1.059), (I-655)+(1.051)+(1.060), (I-655)+(1.051)+(1.061), (I-655)+(1.051)+(1.062), (I-655)+(1.051)+(1.063), (I-655)+(1.051)+(1.064), (I-655)+(1.051)+(1.065), (I-655)+(1.051)+(1.066), (I-655)+(1.051)+(1.067), (I-655)+(1.051)+(1.068), (I-655)+(1.051)+(1.069), (I-655)+(1.051)+(1.070), (I-655)+(1.051)+(1.071), (I-655)+(1.051)+(1.072), (I-655)+(1.051)+(1.073), (I-655)+(1.051)+(1.074), (I-655)+(1.051)+(1.075), (I-655)+(1.051)+(1.076), (I-655)+(1.051)+(1.077), (I-655)+(1.051)+(1.078), (I-655)+(1.051)+(1.079), (I-655)+(1.051)+(1.080), (I-655)+(1.051)+(1.081), (I-655)+(1.051)+(1.082), (I-655)+(1.051)+(1.083), (I-655)+(1.051)+(1.084), (I-655)+(1.051)+(1.085), (I-655)+(1.051)+(1.086), (I-655)+(1.051)+(1.087), (I-655)+(1.051)+(1.088), (I-655)+(1.051)+(1.089), (I-655)+(1.051)+(1.090), (I-655)+(1.051)+(1.091), (I-655)+(1.051)+(1.092), (I-655)+(1.051)+(2.001), (I-655)+(1.051)+(2.002), (I-655)+(1.051)+(2.003), (I-655)+(1.051)+(2.004), (I-655)+(1.051)+(2.005), (I-655)+(1.051)+(2.006), (I-655)+(1.051)+(2.007), (I-655)+(1.051)+(2.008), (I-655)+(1.051)+(2.009), (I-655)+(1.051)+(2.010), (I-655)+(1.051)+(2.011), (I-655)+(1.051)+(2.012), (I-655)+(1.051)+(2.013), (I-655)+(1.051)+(2.014), (I-655)+(1.051)+(2.015), (I-655)+(1.051)+(2.016), (I-655)+(1.051)+(2.017), (I-655)+(1.051)+(2.018), (I-655)+(1.051)+(2.019), (I-655)+(1.051)+(2.020), (I-655)+(1.051)+(2.021), (I-655)+(1.051)+(2.022), (I-655)+(1.051)+(2.023), (I-655)+(1.051)+(2.024), (I-655)+(1.051)+(2.025), (I-655)+(1.051)+(2.026), (I-655)+(1.051)+(2.027), (I-655)+(1.051)+(2.028), (I-655)+(1.051)+(2.029), (I-655)+(1.051)+(2.030), (I-655)+(1.051)+(2.031), (I-655)+(1.051)+(2.032), (I-655)+(1.051)+(2.033), (I-655)+(1.051)+(2.034), (I-655)+(1.051)+(2.035), (I-655)+(1.051)+(2.036), (I-655)+(1.051)+(2.037), (I-655)+(1.051)+(2.038), (I-655)+(1.051)+(2.039), (I-655)+(1.051)+(2.040), (I-655)+(1.051)+(2.041), (I-655)+(1.051)+(2.042), (I-655)+(1.051)+(2.043), (I-655)+(1.051)+(2.044), (I-655)+(1.051)+(2.045), (I-655)+(1.051)+(2.046), (I-655)+(1.051)+(2.047), (I-655)+(1.051)+(2.048), (I-655)+(1.051)+(2.049), (I-655)+(1.051)+(2.050), (I-655)+(1.051)+(2.051), (I-655)+(1.051)+(2.052), (I-655)+(1.051)+(2.053), (I-655)+(1.051)+(2.054), (I-655)+(1.051)+(2.055), (I-655)+(1.051)+(2.056), (I-655)+(1.051)+(2.057), (I-655)+(1.051)+(2.058), (I-655)+(1.051)+(2.059), (I-655)+(1.051)+(3.001), (I-655)+(1.051)+(3.002), (I-655)+(1.051)+(3.003), (I-655)+(1.051)+(3.004), (I-655)+(1.051)+(3.005), (I-655)+(1.051)+(3.006), (I-655)+(1.051)+(3.007), (I-655)+(1.051)+(3.008), (I-655)+(1.051)+(3.009), (I-655)+(1.051)+(3.010), (I-655)+(1.051)+(3.011), (I-655)+(1.051)+(3.012), (I-655)+(1.051)+(3.013), (I-655)+(1.051)+(3.014), (I-655)+(1.051)+(3.015), (I-655)+(1.051)+(3.016), (I-655)+(1.051)+(3.017), (I-655)+(1.051)+(3.018), (I-655)+(1.051)+(3.019), (I-655)+(1.051)+(3.020), (I-655)+(1.051)+(3.021), (I-655)+(1.051)+(3.022), (I-655)+(1.051)+(3.023), (I-655)+(1.051)+(3.024), (I-655)+(1.051)+(3.025), (I-655)+(1.051)+(3.026), (I-655)+(1.051)+(3.027), (I-655)+(1.051)+(3.028), (I-655)+(1.051)+(3.029), (I-655)+(1.051)+(3.030), (I-655)+(1.051)+(3.031), (I-655)+(1.051)+(5.001), (I-655)+(1.051)+(5.002), (I-655)+(1.051)+(5.003), (I-655)+(1.051)+(5.004), (I-655)+(1.051)+(5.005), (I-655)+(1.051)+(5.006), (I-655)+(1.051)+(5.007), (I-655)+(1.051)+(5.008), (I-655)+(1.051)+(5.009), (I-655)+(1.051)+(5.010), (I-655)+(1.051)+(5.011), (I-655)+(1.051)+(5.012), (I-655)+(1.051)+(5.013), (I-655)+(1.051)+(5.014), (I-655)+(1.051)+(5.015), (I-655)+(1.051)+(5.016), (I-655)+(1.051)+(5.017), (I-655)+(1.051)+(5.018), (I-655)+(1.051)+(5.019), (I-655)+(1.051)+(5.020), (I-655)+(1.051)+(5.021), (I-655)+(1.051)+(5.022), (I-655)+(1.051)+(5.023), (I-655)+(1.051)+(6.001), (I-655)+(1.051)+(6.002), (I-655)+(1.051)+(6.003), (I-655)+(1.051)+(6.004), (I-655)+(1.051)+(7.001), (I-655)+(1.051)+(7.002), (I-655)+(1.051)+(7.003), (I-655)+(1.051)+(7.004), (I-655)+(1.051)+(7.005), (I-655)+(1.051)+(7.006), (I-655)+(1.051)+(9.001), (I-655)+(1.051)+(9.002), (I-655)+(1.051)+(9.003), (I-655)+(1.051)+(9.004), (I-655)+(1.051)+(9.005), (I-655)+(1.051)+(9.006), (I-655)+(1.051)+(9.007), (I-655)+(1.051)+(9.008), (I-655)+(1.051)+(9.009), (I-655)+(1.051)+(14.001), (I-655)+(1.051)+(14.002), (I-655)+(1.051)+(15.008), (I-655)+(1.051)+(15.011), (I-655)+(1.051)+(15.012), (I-655)+(1.051)+(15.016), (I-655)+(1.051)+(15.025), (I-655)+(1.051)+(15.027), (I-655)+(1.051)+(15.047), (I-655)+(1.051)+(15.063), (I-655)+(1.051)+(15.064), (I-655)+(1.051)+(16.001), (I-655)+(1.051)+(16.002), (I-655)+(1.051)+(16.003), (I-655)+(1.051)+(16.004), (I-655)+(1.051)+(16.005), (I-655)+(1.051)+(16.006), (I-655)+(1.051)+(16.007), (I-655)+(1.051)+(16.008), (I-655)+(1.051)+(17.001), (I-655)+(1.051)+(17.002), (I-655)+(1.051)+(17.003), (I-655)+(1.051)+(17.004), (I-655)+(1.051)+(17.005), (I-655)+(1.051)+(17.006), (I-655)+(1.051)+(17.007), (I-655)+(1.051)+(17.008), (I-655)+(1.051)+(17.009), (I-655)+(1.051)+(17.010), (I-655)+(1.051)+(17.011), (I-655)+(1.051)+(17.012), (I-655)+(1.051)+(18.001),

(I-655)+(1.052)+(1.053), (I-655)+(1.052)+(1.054), (I-655)+(1.052)+(1.055), (I-655)+(1.052)+(1.056), (I-655)+(1.052)+(1.057), (I-655)+(1.052)+(1.058), (I-655)+(1.052)+(1.059), (I-655)+(1.052)+(1.060), (I-655)+(1.052)+(1.061), (I-655)+(1.052)+(1.062), (I-655)+(1.052)+(1.063), (I-655)+(1.052)+(1.064), (I-655)+(1.052)+(1.065), (I-655)+(1.052)+(1.066), (I-655)+(1.052)+(1.067), (I-655)+(1.052)+(1.068), (I-655)+(1.052)+(1.069), (I-655)+(1.052)+(1.070), (I-655)+(1.052)+(1.071), (I-655)+(1.052)+(1.072), (I-655)+(1.052)+(1.073), (I-655)+(1.052)+(1.074), (I-655)+(1.052)+(1.075), (I-655)+(1.052)+(1.076), (I-655)+(1.052)+(1.077), (I-655)+(1.052)+(1.078), (I-655)+(1.052)+(1.079), (I-655)+(1.052)+(1.080), (I-655)+(1.052)+(1.081), (I-655)+(1.052)+(1.082), (I-655)+(1.052)+(1.083), (I-655)+(1.052)+(1.084), (I-655)+(1.052)+(1.085), (I-655)+(1.052)+(1.086), (I-655)+(1.052)+(1.087), (I-655)+(1.052)+(1.088), (I-655)+(1.052)+(1.089), (I-655)+(1.052)+(1.090), (I-655)+(1.052)+(1.091), (I-655)+(1.052)+(1.092), (I-655)+(1.052)+(2.001), (I-655)+(1.052)+(2.002), (I-655)+(1.052)+(2.003), (I-655)+(1.052)+(2.004), (I-655)+(1.052)+(2.005), (I-655)+(1.052)+(2.006), (I-655)+(1.052)+(2.007), (I-655)+(1.052)+(2.008), (I-655)+(1.052)+(2.009), (I-655)+(1.052)+(2.010), (I-655)+(1.052)+(2.011), (I-655)+(1.052)+(2.012), (I-655)+(1.052)+(2.013), (I-655)+(1.052)+(2.014), (I-655)+(1.052)+(2.015), (I-655)+(1.052)+(2.016), (I-655)+(1.052)+(2.017), (I-655)+(1.052)+(2.018), (I-655)+(1.052)+(2.019), (I-655)+(1.052)+(2.020), (I-655)+(1.052)+(2.021), (I-655)+(1.052)+(2.022), (I-655)+(1.052)+(2.023), (I-655)+(1.052)+(2.024), (I-655)+(1.052)+(2.025), (I-655)+(1.052)+(2.026), (I-655)+(1.052)+(2.027), (I-655)+(1.052)+(2.028), (I-655)+(1.052)+(2.029), (I-655)+(1.052)+(2.030), (I-655)+(1.052)+(2.031), (I-655)+(1.052)+(2.032), (I-655)+(1.052)+(2.033), (I-655)+(1.052)+(2.034), (I-655)+(1.052)+(2.035), (I-655)+(1.052)+(2.036), (I-655)+(1.052)+(2.037), (I-655)+(1.052)+(2.038), (I-655)+(1.052)+(2.039), (I-655)+(1.052)+(2.040), (I-655)+(1.052)+(2.041), (I-655)+(1.052)+(2.042), (I-655)+(1.052)+(2.043), (I-655)+(1.052)+(2.044), (I-655)+(1.052)+(2.045), (I-655)+(1.052)+(2.046), (I-655)+(1.052)+(2.047), (I-655)+(1.052)+(2.048), (I-655)+(1.052)+(2.049), (I-655)+(1.052)+(2.050), (I-655)+(1.052)+(2.051), (I-655)+(1.052)+(2.052), (I-655)+(1.052)+(2.053), (I-655)+(1.052)+(2.054), (I-655)+(1.052)+(2.055), (I-655)+(1.052)+(2.056), (I-655)+(1.052)+(2.057), (I-655)+(1.052)+(2.058), (I-655)+(1.052)+(2.059), (I-655)+(1.052)+(3.001), (I-655)+(1.052)+(3.002), (I-655)+(1.052)+(3.003), (I-655)+(1.052)+(3.004), (I-655)+(1.052)+(3.005), (I-655)+(1.052)+(3.006), (I-655)+(1.052)+(3.007), (I-655)+(1.052)+(3.008), (I-655)+(1.052)+(3.009), (I-655)+(1.052)+(3.010), (I-655)+(1.052)+(3.011), (I-655)+(1.052)+(3.012), (I-655)+(1.052)+(3.013), (I-655)+(1.052)+(3.014), (I-655)+(1.052)+(3.015), (I-655)+(1.052)+(3.016), (I-655)+(1.052)+(3.017), (I-655)+(1.052)+(3.018), (I-655)+(1.052)+(3.019), (I-655)+(1.052)+(3.020), (I-655)+(1.052)+(3.021), (I-655)+(1.052)+(3.022), (I-655)+(1.052)+(3.023), (I-655)+(1.052)+(3.024), (I-655)+(1.052)+(3.025), (I-655)+(1.052)+(3.026), (I-655)+(1.052)+(3.027), (I-655)+(1.052)+(3.028), (I-655)+(1.052)+(3.029), (I-655)+(1.052)+(3.030), (I-655)+(1.052)+(3.031), (I-655)+(1.052)+(5.001), (I-655)+(1.052)+(5.002), (I-655)+(1.052)+(5.003), (I-655)+(1.052)+(5.004), (I-655)+(1.052)+(5.005), (I-655)+(1.052)+(5.006), (I-655)+(1.052)+(5.007), (I-655)+(1.052)+(5.008), (I-655)+(1.052)+(5.009), (I-655)+(1.052)+(5.010), (I-655)+(1.052)+(5.011), (I-655)+(1.052)+(5.012), (I-655)+(1.052)+(5.013), (I-655)+(1.052)+(5.014), (I-655)+(1.052)+(5.015), (I-655)+(1.052)+(5.016), (I-655)+(1.052)+(5.017), (I-655)+(1.052)+(5.018), (I-655)+(1.052)+(5.019), (I-655)+(1.052)+(5.020), (I-655)+(1.052)+(5.021), (I-655)+(1.052)+(5.022), (I-655)+(1.052)+(5.023), (I-655)+(1.052)+(6.001), (I-655)+(1.052)+(6.002), (I-655)+(1.052)+(6.003), (I-655)+(1.052)+(6.004), (I-655)+(1.052)+(7.001), (I-655)+(1.052)+(7.002), (I-655)+(1.052)+(7.003), (I-655)+(1.052)+(7.004), (I-655)+(1.052)+(7.005), (I-655)+(1.052)+(7.006), (I-655)+(1.052)+(9.001), (I-655)+(1.052)+(9.002), (I-655)+(1.052)+(9.003), (I-655)+(1.052)+(9.004), (I-655)+(1.052)+(9.005), (I-655)+(1.052)+(9.006), (I-655)+(1.052)+(9.007), (I-655)+(1.052)+(9.008), (I-655)+(1.052)+(9.009), (I-655)+(1.052)+(14.001), (I-655)+(1.052)+(14.002), (I-655)+(1.052)+(15.008), (I-655)+(1.052)+(15.011), (I-655)+(1.052)+(15.012), (I-655)+(1.052)+(15.016), (I-655)+(1.052)+(15.025), (I-655)+(1.052)+(15.027), (I-655)+(1.052)+(15.047), (I-655)+(1.052)+(15.063), (I-655)+(1.052)+(15.064), (I-655)+(1.052)+(16.001), (I-655)+(1.052)+(16.002), (I-655)+(1.052)+(16.003), (I-655)+(1.052)+(16.004), (I-655)+(1.052)+(16.005), (I-655)+(1.052)+(16.006), (I-655)+(1.052)+(16.007), (I-655)+(1.052)+(16.008), (I-655)+(1.052)+(17.001), (I-655)+(1.052)+(17.002), (I-655)+(1.052)+(17.003), (I-655)+(1.052)+(17.004), (I-655)+(1.052)+(17.005), (I-655)+(1.052)+(17.006), (I-655)+(1.052)+(17.007), (I-655)+(1.052)+(17.008), (I-655)+(1.052)+(17.009), (I-655)+(1.052)+(17.010), (I-655)+(1.052)+(17.011), (I-655)+(1.052)+(17.012), (I-655)+(1.052)+(18.001),

(I-655)+(1.053)+(1.054), (I-655)+(1.053)+(1.055), (I-655)+(1.053)+(1.056), (I-655)+(1.053)+(1.057), (I-655)+(1.053)+(1.058), (I-655)+(1.053)+(1.059), (I-655)+(1.053)+(1.060), (I-655)+(1.053)+(1.061), (I-655)+(1.053)+(1.062), (I-655)+(1.053)+(1.063), (I-655)+(1.053)+(1.064), (I-655)+(1.053)+(1.065), (I-655)+(1.053)+(1.066), (I-655)+(1.053)+(1.067), (I-655)+(1.053)+(1.068), (I-655)+(1.053)+(1.069), (I-655)+(1.053)+(1.070), (I-655)+(1.053)+(1.071), (I-655)+(1.053)+(1.072), (I-655)+(1.053)+(1.073), (I-655)+(1.053)+(1.074), (I-655)+(1.053)+(1.075), (I-655)+(1.053)+(1.076), (I-655)+(1.053)+(1.077), (I-655)+(1.053)+(1.078), (I-655)+(1.053)+(1.079), (I-655)+(1.053)+(1.080), (I-655)+(1.053)+(1.081), (I-655)+(1.053)+(1.082), (I-655)+(1.053)+(1.083), (I-655)+(1.053)+(1.084), (I-655)+(1.053)+(1.085), (I-655)+(1.053)+(1.086), (I-655)+(1.053)+(1.087), (I-655)+(1.053)+(1.088), (I-655)+(1.053)+(1.089), (I-655)+(1.053)+(1.090), (I-655)+(1.053)+(1.091), (I-655)+(1.053)+(1.092), (I-655)+(1.053)+(2.001), (I-655)+(1.053)+(2.002), (I-655)+(1.053)+(2.003), (I-655)+(1.053)+(2.004), (I-655)+(1.053)+(2.005), (I-655)+(1.053)+(2.006), (I-655)+(1.053)+(2.007), (I-655)+(1.053)+(2.008), (I-655)+(1.053)+(2.009), (I-655)+(1.053)+(2.010), (I-655)+(1.053)+(2.011), (I-655)+(1.053)+(2.012), (I-655)+(1.053)+(2.013), (I-655)+(1.053)+(2.014), (I-655)+(1.053)+(2.015), (I-655)+(1.053)+(2.016), (I-655)+(1.053)+(2.017), (I-655)+(1.053)+(2.018), (I-655)+(1.053)+(2.019), (I-655)+(1.053)+(2.020), (I-655)+(1.053)+(2.021), (I-655)+(1.053)+(2.022), (I-655)+(1.053)+(2.023), (I-655)+(1.053)+(2.024), (I-655)+(1.053)+(2.025), (I-655)+(1.053)+(2.026), (I-655)+(1.053)+(2.027), (I-655)+(1.053)+(2.028), (I-655)+(1.053)+(2.029), (I-655)+(1.053)+(2.030), (I-655)+(1.053)+(2.031), (I-655)+(1.053)+(2.032), (I-655)+(1.053)+(2.033), (I-655)+(1.053)+(2.034), (I-655)+(1.053)+(2.035), (I-655)+(1.053)+(2.036), (I-655)+(1.053)+(2.037), (I-655)+(1.053)+(2.038), (I-655)+(1.053)+(2.039), (I-655)+(1.053)+(2.040), (I-655)+(1.053)+(2.041), (I-655)+(1.053)+(2.042), (I-655)+(1.053)+(2.043), (I-655)+(1.053)+(2.044), (I-655)+(1.053)+(2.045), (I-655)+(1.053)+(2.046), (I-655)+(1.053)+(2.047), (I-655)+(1.053)+(2.048), (I-655)+(1.053)+(2.049), (I-655)+(1.053)+(2.050), (I-655)+(1.053)+(2.051), (I-655)+(1.053)+(2.052), (I-655)+(1.053)+(2.053), (I-655)+(1.053)+(2.054), (I-655)+(1.053)+(2.055), (I-655)+(1.053)+(2.056), (I-655)+(1.053)+(2.057), (I-655)+(1.053)+(2.058), (I-655)+(1.053)+(2.059), (I-655)+(1.053)+(3.001), (I-655)+(1.053)+(3.002), (I-655)+(1.053)+(3.003), (I-655)+(1.053)+(3.004), (I-655)+(1.053)+(3.005), (I-655)+(1.053)+(3.006), (I-655)+(1.053)+(3.007), (I-655)+(1.053)+(3.008), (I-655)+(1.053)+(3.009), (I-655)+(1.053)+(3.010), (I-655)+(1.053)+(3.011), (I-655)+(1.053)+(3.012), (I-655)+(1.053)+(3.013), (I-655)+(1.053)+(3.014), (I-655)+(1.053)+(3.015), (I-655)+(1.053)+(3.016), (I-655)+(1.053)+(3.017), (I-655)+(1.053)+(3.018), (I-655)+(1.053)+(3.019), (I-655)+(1.053)+(3.020), (I-655)+(1.053)+(3.021), (I-655)+(1.053)+(3.022), (I-655)+(1.053)+(3.023), (I-655)+(1.053)+(3.024), (I-655)+(1.053)+(3.025), (I-655)+(1.053)+(3.026), (I-655)+(1.053)+(3.027), (I-655)+(1.053)+(3.028), (I-655)+(1.053)+(3.029), (I-655)+(1.053)+(3.030), (I-655)+(1.053)+(3.031), (I-655)+(1.053)+(5.001), (I-655)+(1.053)+(5.002), (I-655)+(1.053)+(5.003), (I-655)+(1.053)+(5.004), (I-655)+(1.053)+(5.005), (I-655)+(1.053)+(5.006), (I-655)+(1.053)+(5.007), (I-655)+(1.053)+(5.008), (I-655)+(1.053)+(5.009), (I-655)+(1.053)+(5.010), (I-655)+(1.053)+(5.011), (I-655)+(1.053)+(5.012), (I-655)+(1.053)+(5.013), (I-655)+(1.053)+(5.014), (I-655)+(1.053)+(5.015), (I-655)+(1.053)+(5.016), (I-655)+(1.053)+(5.017), (I-655)+(1.053)+(5.018), (I-655)+(1.053)+(5.019), (I-655)+(1.053)+(5.020), (I-655)+(1.053)+(5.021), (I-655)+(1.053)+(5.022), (I-655)+(1.053)+(5.023), (I-655)+(1.053)+(6.001), (I-655)+(1.053)+(6.002), (I-655)+(1.053)+(6.003), (I-655)+(1.053)+(6.004), (I-655)+(1.053)+(7.001), (I-655)+(1.053)+(7.002), (I-655)+(1.053)+(7.003), (I-655)+(1.053)+(7.004), (I-655)+(1.053)+(7.005), (I-655)+(1.053)+(7.006), (I-655)+(1.053)+(9.001), (I-655)+(1.053)+(9.002), (I-655)+(1.053)+(9.003), (I-655)+(1.053)+(9.004), (I-655)+(1.053)+(9.005), (I-655)+(1.053)+(9.006), (I-655)+(1.053)+(9.007), (I-655)+(1.053)+(9.008), (I-655)+(1.053)+(9.009), (I-655)+(1.053)+(14.001), (I-655)+(1.053)+(14.002), (I-655)+(1.053)+(15.008), (I-655)+(1.053)+(15.011), (I-655)+(1.053)+(15.012), (I-655)+(1.053)+(15.016), (I-655)+(1.053)+(15.025), (I-655)+(1.053)+(15.027), (I-655)+(1.053)+(15.047), (I-655)+(1.053)+(15.063), (I-655)+(1.053)+(15.064), (I-655)+(1.053)+(16.001), (I-655)+(1.053)+(16.002), (I-655)+(1.053)+(16.003), (I-655)+(1.053)+(16.004), (I-655)+(1.053)+(16.005), (I-655)+(1.053)+(16.006), (I-655)+(1.053)+(16.007), (I-655)+(1.053)+(16.008), (I-655)+(1.053)+(17.001), (I-655)+(1.053)+(17.002), (I-655)+(1.053)+(17.003), (I-655)+(1.053)+(17.004), (I-655)+(1.053)+(17.005), (I-655)+(1.053)+(17.006), (I-655)+(1.053)+(17.007), (I-655)+(1.053)+(17.008), (I-655)+(1.053)+(17.009), (I-655)+(1.053)+(17.010), (I-655)+(1.053)+(17.011), (I-655)+(1.053)+(17.012), (I-655)+(1.053)+(18.001),

(I-655)+(1.054)+(1.055), (I-655)+(1.054)+(1.056), (I-655)+(1.054)+(1.057), (I-655)+(1.054)+(1.058), (I-655)+(1.054)+(1.059), (I-655)+(1.054)+(1.060), (I-655)+(1.054)+(1.061), (I-655)+(1.054)+(1.062), (I-655)+(1.054)+(1.063), (I-655)+(1.054)+(1.064), (I-655)+(1.054)+(1.065), (I-655)+(1.054)+(1.066), (I-655)+(1.054)+(1.067), (I-655)+(1.054)+(1.068), (I-655)+(1.054)+(1.069), (I-655)+(1.054)+(1.070), (I-655)+(1.054)+(1.071), (I-655)+(1.054)+(1.072), (I-655)+(1.054)+(1.073), (I-655)+(1.054)+(1.074), (I-655)+(1.054)+(1.075), (I-655)+(1.054)+(1.076), (I-655)+(1.054)+(1.077), (I-655)+(1.054)+(1.078), (I-655)+(1.054)+(1.079), (I-655)+(1.054)+(1.080), (I-655)+(1.054)+(1.081), (I-655)+(1.054)+(1.082), (I-655)+(1.054)+(1.083), (I-655)+(1.054)+(1.084), (I-655)+(1.054)+(1.085), (I-655)+(1.054)+(1.086), (I-655)+(1.054)+(1.087), (I-655)+(1.054)+(1.088), (I-655)+(1.054)+(1.089), (I-655)+(1.054)+(1.090), (I-655)+(1.054)+(1.091), (I-655)+(1.054)+(1.092), (I-655)+(1.054)+(2.001), (I-655)+(1.054)+(2.002), (I-655)+(1.054)+(2.003), (I-655)+(1.054)+(2.004), (I-655)+(1.054)+(2.005), (I-655)+(1.054)+(2.006), (I-655)+(1.054)+(2.007), (I-655)+(1.054)+(2.008), (I-655)+(1.054)+(2.009), (I-655)+(1.054)+(2.010), (I-655)+(1.054)+(2.011), (I-655)+(1.054)+(2.012), (I-655)+(1.054)+(2.013), (I-655)+(1.054)+(2.014), (I-655)+(1.054)+(2.015), (I-655)+(1.054)+(2.016), (I-655)+(1.054)+(2.017), (I-655)+(1.054)+(2.018), (I-655)+(1.054)+(2.019), (I-655)+(1.054)+(2.020), (I-655)+(1.054)+(2.021), (I-655)+(1.054)+(2.022), (I-655)+(1.054)+(2.023), (I-655)+(1.054)+(2.024), (I-655)+(1.054)+(2.025), (I-655)+(1.054)+(2.026), (I-655)+(1.054)+(2.027), (I-655)+(1.054)+(2.028), (I-655)+(1.054)+(2.029), (I-655)+(1.054)+(2.030), (I-655)+(1.054)+(2.031), (I-655)+(1.054)+(2.032), (I-655)+(1.054)+(2.033), (I-655)+(1.054)+(2.034), (I-655)+(1.054)+(2.035), (I-655)+(1.054)+(2.036), (I-655)+(1.054)+(2.037), (I-655)+(1.054)+(2.038), (I-655)+(1.054)+(2.039), (I-655)+(1.054)+(2.040), (I-655)+(1.054)+(2.041), (I-655)+(1.054)+(2.042), (I-655)+(1.054)+(2.043), (I-655)+(1.054)+(2.044), (I-655)+(1.054)+(2.045), (I-655)+(1.054)+(2.046), (I-655)+(1.054)+(2.047), (I-655)+(1.054)+(2.048), (I-655)+(1.054)+(2.049), (I-655)+(1.054)+(2.050), (I-655)+(1.054)+(2.051), (I-655)+(1.054)+(2.052), (I-655)+(1.054)+(2.053), (I-655)+(1.054)+(2.054), (I-655)+(1.054)+(2.055), (I-655)+(1.054)+(2.056), (I-655)+(1.054)+(2.057), (I-655)+(1.054)+(2.058), (I-655)+(1.054)+(2.059), (I-655)+(1.054)+(3.001), (I-655)+(1.054)+(3.002), (I-655)+(1.054)+(3.003), (I-655)+(1.054)+(3.004), (I-655)+(1.054)+(3.005), (I-655)+(1.054)+(3.006), (I-655)+(1.054)+(3.007), (I-655)+(1.054)+(3.008), (I-655)+(1.054)+(3.009), (I-655)+(1.054)+(3.010), (I-655)+(1.054)+(3.011), (I-655)+(1.054)+(3.012), (I-655)+(1.054)+(3.013), (I-655)+(1.054)+(3.014), (I-655)+(1.054)+(3.015), (I-655)+(1.054)+(3.016), (I-655)+(1.054)+(3.017), (I-655)+(1.054)+(3.018), (I-655)+(1.054)+(3.019), (I-655)+(1.054)+(3.020), (I-655)+(1.054)+(3.021), (I-655)+(1.054)+(3.022), (I-655)+(1.054)+(3.023), (I-655)+(1.054)+(3.024), (I-655)+(1.054)+(3.025), (I-655)+(1.054)+(3.026), (I-655)+(1.054)+(3.027), (I-655)+(1.054)+(3.028), (I-655)+(1.054)+(3.029), (I-655)+(1.054)+(3.030), (I-655)+(1.054)+(3.031), (I-655)+(1.054)+(5.001), (I-655)+(1.054)+(5.002), (I-655)+(1.054)+(5.003), (I-655)+(1.054)+(5.004), (I-655)+(1.054)+(5.005), (I-655)+(1.054)+(5.006), (I-655)+(1.054)+(5.007), (I-655)+(1.054)+(5.008), (I-655)+(1.054)+(5.009), (I-655)+(1.054)+(5.010), (I-655)+(1.054)+(5.011), (I-655)+(1.054)+(5.012), (I-655)+(1.054)+(5.013), (I-655)+(1.054)+(5.014), (I-655)+(1.054)+(5.015), (I-655)+(1.054)+(5.016), (I-655)+(1.054)+(5.017), (I-655)+(1.054)+(5.018), (I-655)+(1.054)+(5.019), (I-655)+(1.054)+(5.020), (I-655)+(1.054)+(5.021), (I-655)+(1.054)+(5.022), (I-655)+(1.054)+(5.023), (I-655)+(1.054)+(6.001), (I-655)+(1.054)+(6.002), (I-655)+(1.054)+(6.003), (I-655)+(1.054)+(6.004), (I-655)+(1.054)+(7.001), (I-655)+(1.054)+(7.002), (I-655)+(1.054)+(7.003), (I-655)+(1.054)+(7.004), (I-655)+(1.054)+(7.005), (I-655)+(1.054)+(7.006), (I-655)+(1.054)+(9.001), (I-655)+(1.054)+(9.002), (I-655)+(1.054)+(9.003), (I-655)+(1.054)+(9.004), (I-655)+(1.054)+(9.005), (I-655)+(1.054)+(9.006), (I-655)+(1.054)+(9.007), (I-655)+(1.054)+(9.008), (I-655)+(1.054)+(9.009), (I-655)+(1.054)+(14.001), (I-655)+(1.054)+(14.002), (I-655)+(1.054)+(15.008), (I-655)+(1.054)+(15.011), (I-655)+(1.054)+(15.012), (I-655)+(1.054)+(15.016), (I-655)+(1.054)+(15.025), (I-655)+(1.054)+(15.027), (I-655)+(1.054)+(15.047), (I-655)+(1.054)+(15.063), (I-655)+(1.054)+(15.064), (I-655)+(1.054)+(16.001), (I-655)+(1.054)+(16.002), (I-655)+(1.054)+(16.003), (I-655)+(1.054)+(16.004), (I-655)+(1.054)+(16.005), (I-655)+(1.054)+(16.006), (I-655)+(1.054)+(16.007), (I-655)+(1.054)+(16.008), (I-655)+(1.054)+(17.001), (I-655)+(1.054)+(17.002), (I-655)+(1.054)+(17.003), (I-655)+(1.054)+(17.004), (I-655)+(1.054)+(17.005), (I-655)+(1.054)+(17.006), (I-655)+(1.054)+(17.007), (I-655)+(1.054)+(17.008), (I-655)+(1.054)+(17.009), (I-655)+(1.054)+(17.010), (I-655)+(1.054)+(17.011), (I-655)+(1.054)+(17.012), (I-655)+(1.054)+(18.001),

(I-655)+(1.055)+(1.056), (I-655)+(1.055)+(1.057), (I-655)+(1.055)+(1.058), (I-655)+(1.055)+(1.059), (I-655)+(1.055)+(1.060), (I-655)+(1.055)+(1.061), (I-655)+(1.055)+(1.062), (I-655)+(1.055)+(1.063), (I-655)+(1.055)+(1.064), (I-655)+(1.055)+(1.065), (I-655)+(1.055)+(1.066), (I-655)+(1.055)+(1.067), (I-655)+(1.055)+(1.068), (I-655)+(1.055)+(1.069), (I-655)+(1.055)+(1.070), (I-655)+(1.055)+(1.071), (I-655)+(1.055)+(1.072), (I-655)+(1.055)+(1.073), (I-655)+(1.055)+(1.074), (I-655)+(1.055)+(1.075), (I-655)+(1.055)+(1.076), (I-655)+(1.055)+(1.077), (I-655)+(1.055)+(1.078), (I-655)+(1.055)+(1.079), (I-655)+(1.055)+(1.080), (I-655)+(1.055)+(1.081), (I-655)+(1.055)+(1.082), (I-655)+(1.055)+(1.083), (I-655)+(1.055)+(1.084), (I-655)+(1.055)+(1.085), (I-655)+(1.055)+(1.086), (I-655)+(1.055)+(1.087), (I-655)+(1.055)+(1.088), (I-655)+(1.055)+(1.089), (I-655)+(1.055)+(1.090), (I-655)+(1.055)+(1.091), (I-655)+(1.055)+(1.092), (I-655)+(1.055)+(2.001), (I-655)+(1.055)+(2.002), (I-655)+(1.055)+(2.003), (I-655)+(1.055)+(2.004), (I-655)+(1.055)+(2.005), (I-655)+(1.055)+(2.006), (I-655)+(1.055)+(2.007), (I-655)+(1.055)+(2.008), (I-655)+(1.055)+(2.009), (I-655)+(1.055)+(2.010), (I-655)+(1.055)+(2.011), (I-655)+(1.055)+(2.012), (I-655)+(1.055)+(2.013), (I-655)+(1.055)+(2.014), (I-655)+(1.055)+(2.015), (I-655)+(1.055)+(2.016), (I-655)+(1.055)+(2.017), (I-655)+(1.055)+(2.018), (I-655)+(1.055)+(2.019), (I-655)+(1.055)+(2.020), (I-655)+(1.055)+(2.021), (I-655)+(1.055)+(2.022), (I-655)+(1.055)+(2.023), (I-655)+(1.055)+(2.024), (I-655)+(1.055)+(2.025), (I-655)+(1.055)+(2.026), (I-655)+(1.055)+(2.027), (I-655)+(1.055)+(2.028), (I-655)+(1.055)+(2.029), (I-655)+(1.055)+(2.030), (I-655)+(1.055)+(2.031), (I-655)+(1.055)+(2.032), (I-655)+(1.055)+(2.033), (I-655)+(1.055)+(2.034), (I-655)+(1.055)+(2.035), (I-655)+(1.055)+(2.036), (I-655)+(1.055)+(2.037), (I-655)+(1.055)+(2.038), (I-655)+(1.055)+(2.039), (I-655)+(1.055)+(2.040), (I-655)+(1.055)+(2.041), (I-655)+(1.055)+(2.042), (I-655)+(1.055)+(2.043), (I-655)+(1.055)+(2.044), (I-655)+(1.055)+(2.045), (I-655)+(1.055)+(2.046), (I-655)+(1.055)+(2.047), (I-655)+(1.055)+(2.048), (I-655)+(1.055)+(2.049), (I-655)+(1.055)+(2.050), (I-655)+(1.055)+(2.051), (I-655)+(1.055)+(2.052), (I-655)+(1.055)+(2.053), (I-655)+(1.055)+(2.054), (I-655)+(1.055)+(2.055), (I-655)+(1.055)+(2.056), (I-655)+(1.055)+(2.057), (I-655)+(1.055)+(2.058), (I-655)+(1.055)+(2.059), (I-655)+(1.055)+(3.001), (I-655)+(1.055)+(3.002), (I-655)+(1.055)+(3.003), (I-655)+(1.055)+(3.004), (I-655)+(1.055)+(3.005), (I-655)+(1.055)+(3.006), (I-655)+(1.055)+(3.007), (I-655)+(1.055)+(3.008), (I-655)+(1.055)+(3.009), (I-655)+(1.055)+(3.010), (I-655)+(1.055)+(3.011), (I-655)+(1.055)+(3.012), (I-655)+(1.055)+(3.013), (I-655)+(1.055)+(3.014), (I-655)+(1.055)+(3.015), (I-655)+(1.055)+(3.016), (I-655)+(1.055)+(3.017), (I-655)+(1.055)+(3.018), (I-655)+(1.055)+(3.019), (I-655)+(1.055)+(3.020), (I-655)+(1.055)+(3.021), (I-655)+(1.055)+(3.022), (I-655)+(1.055)+(3.023), (I-655)+(1.055)+(3.024), (I-655)+(1.055)+(3.025), (I-655)+(1.055)+(3.026), (I-655)+(1.055)+(3.027), (I-655)+(1.055)+(3.028), (I-655)+(1.055)+(3.029), (I-655)+(1.055)+(3.030), (I-655)+(1.055)+(3.031), (I-655)+(1.055)+(5.001), (I-655)+(1.055)+(5.002), (I-655)+(1.055)+(5.003), (I-655)+(1.055)+(5.004), (I-655)+(1.055)+(5.005), (I-655)+(1.055)+(5.006), (I-655)+(1.055)+(5.007), (I-655)+(1.055)+(5.008), (I-655)+(1.055)+(5.009), (I-655)+(1.055)+(5.010), (I-655)+(1.055)+(5.011), (I-655)+(1.055)+(5.012), (I-655)+(1.055)+(5.013), (I-655)+(1.055)+(5.014), (I-655)+(1.055)+(5.015), (I-655)+(1.055)+(5.016), (I-655)+(1.055)+(5.017), (I-655)+(1.055)+(5.018), (I-655)+(1.055)+(5.019), (I-655)+(1.055)+(5.020), (I-655)+(1.055)+(5.021), (I-655)+(1.055)+(5.022), (I-655)+(1.055)+(5.023), (I-655)+(1.055)+(6.001), (I-655)+(1.055)+(6.002), (I-655)+(1.055)+(6.003), (I-655)+(1.055)+(6.004), (I-655)+(1.055)+(7.001), (I-655)+(1.055)+(7.002), (I-655)+(1.055)+(7.003), (I-655)+(1.055)+(7.004), (I-655)+(1.055)+(7.005), (I-655)+(1.055)+(7.006), (I-655)+(1.055)+(9.001), (I-655)+(1.055)+(9.002), (I-655)+(1.055)+(9.003), (I-655)+(1.055)+(9.004), (I-655)+(1.055)+(9.005), (I-655)+(1.055)+(9.006), (I-655)+(1.055)+(9.007), (I-655)+(1.055)+(9.008), (I-655)+(1.055)+(9.009), (I-655)+(1.055)+(14.001), (I-655)+(1.055)+(14.002), (I-655)+(1.055)+(15.008), (I-655)+(1.055)+(15.011), (I-655)+(1.055)+(15.012), (I-655)+(1.055)+(15.016), (I-655)+(1.055)+(15.025), (I-655)+(1.055)+(15.027), (I-655)+(1.055)+(15.047), (I-655)+(1.055)+(15.063), (I-655)+(1.055)+(15.064), (I-655)+(1.055)+(16.001), (I-655)+(1.055)+(16.002), (I-655)+(1.055)+(16.003), (I-655)+(1.055)+(16.004), (I-655)+(1.055)+(16.005), (I-655)+(1.055)+(16.006), (I-655)+(1.055)+(16.007), (I-655)+(1.055)+(16.008), (I-655)+(1.055)+(17.001), (I-655)+(1.055)+(17.002), (I-655)+(1.055)+(17.003), (I-655)+(1.055)+(17.004), (I-655)+(1.055)+(17.005), (I-655)+(1.055)+(17.006), (I-655)+(1.055)+(17.007), (I-655)+(1.055)+(17.008), (I-655)+(1.055)+(17.009), (I-655)+(1.055)+(17.010), (I-655)+(1.055)+(17.011), (I-655)+(1.055)+(17.012), (I-655)+(1.055)+(18.001),

(I-655)+(1.056)+(1.057), (I-655)+(1.056)+(1.058), (I-655)+(1.056)+(1.059), (I-655)+(1.056)+(1.060), (I-655)+(1.056)+(1.061), (I-655)+(1.056)+(1.062), (I-655)+(1.056)+(1.063), (I-655)+(1.056)+(1.064), (I-655)+(1.056)+(1.065), (I-655)+(1.056)+(1.066), (I-655)+(1.056)+(1.067), (I-655)+(1.056)+(1.068), (I-655)+(1.056)+(1.069), (I-655)+(1.056)+(1.070), (I-655)+(1.056)+(1.071), (I-655)+(1.056)+(1.072), (I-655)+(1.056)+(1.073), (I-655)+(1.056)+(1.074), (I-655)+(1.056)+(1.075), (I-655)+(1.056)+(1.076), (I-655)+(1.056)+(1.077), (I-655)+(1.056)+(1.078), (I-655)+(1.056)+(1.079), (I-655)+(1.056)+(1.080), (I-655)+(1.056)+(1.081), (I-655)+(1.056)+(1.082), (I-655)+(1.056)+(1.083), (I-655)+(1.056)+(1.084), (I-655)+(1.056)+(1.085), (I-655)+(1.056)+(1.086), (I-655)+(1.056)+(1.087), (I-655)+(1.056)+(1.088), (I-655)+(1.056)+(1.089), (I-655)+(1.056)+(1.090), (I-655)+(1.056)+(1.091), (I-655)+(1.056)+(1.092), (I-655)+(1.056)+(2.001), (I-655)+(1.056)+(2.002), (I-655)+(1.056)+(2.003), (I-655)+(1.056)+(2.004), (I-655)+(1.056)+(2.005), (I-655)+(1.056)+(2.006), (I-655)+(1.056)+(2.007), (I-655)+(1.056)+(2.008), (I-655)+(1.056)+(2.009), (I-655)+(1.056)+(2.010), (I-655)+(1.056)+(2.011), (I-655)+(1.056)+(2.012), (I-655)+(1.056)+(2.013), (I-655)+(1.056)+(2.014), (I-655)+(1.056)+(2.015), (I-655)+(1.056)+(2.016), (I-655)+(1.056)+(2.017), (I-655)+(1.056)+(2.018), (I-655)+(1.056)+(2.019), (I-655)+(1.056)+(2.020), (I-655)+(1.056)+(2.021), (I-655)+(1.056)+(2.022), (I-655)+(1.056)+(2.023), (I-655)+(1.056)+(2.024), (I-655)+(1.056)+(2.025), (I-655)+(1.056)+(2.026), (I-655)+(1.056)+(2.027), (I-655)+(1.056)+(2.028), (I-655)+(1.056)+(2.029), (I-655)+(1.056)+(2.030), (I-655)+(1.056)+(2.031), (I-655)+(1.056)+(2.032), (I-655)+(1.056)+(2.033), (I-655)+(1.056)+(2.034), (I-655)+(1.056)+(2.035), (I-655)+(1.056)+(2.036), (I-655)+(1.056)+(2.037), (I-655)+(1.056)+(2.038), (I-655)+(1.056)+(2.039), (I-655)+(1.056)+(2.040), (I-655)+(1.056)+(2.041), (I-655)+(1.056)+(2.042), (I-655)+(1.056)+(2.043), (I-655)+(1.056)+(2.044), (I-655)+(1.056)+(2.045), (I-655)+(1.056)+(2.046), (I-655)+(1.056)+(2.047), (I-655)+(1.056)+(2.048), (I-655)+(1.056)+(2.049), (I-655)+(1.056)+(2.050), (I-655)+(1.056)+(2.051), (I-655)+(1.056)+(2.052), (I-655)+(1.056)+(2.053), (I-655)+(1.056)+(2.054), (I-655)+(1.056)+(2.055), (I-655)+(1.056)+(2.056), (I-655)+(1.056)+(2.057), (I-655)+(1.056)+(2.058), (I-655)+(1.056)+(2.059), (I-655)+(1.056)+(3.001), (I-655)+(1.056)+(3.002), (I-655)+(1.056)+(3.003), (I-655)+(1.056)+(3.004), (I-655)+(1.056)+(3.005), (I-655)+(1.056)+(3.006), (I-655)+(1.056)+(3.007), (I-655)+(1.056)+(3.008), (I-655)+(1.056)+(3.009), (I-655)+(1.056)+(3.010), (I-655)+(1.056)+(3.011), (I-655)+(1.056)+(3.012), (I-655)+(1.056)+(3.013), (I-655)+(1.056)+(3.014), (I-655)+(1.056)+(3.015), (I-655)+(1.056)+(3.016), (I-655)+(1.056)+(3.017), (I-655)+(1.056)+(3.018), (I-655)+(1.056)+(3.019), (I-655)+(1.056)+(3.020), (I-655)+(1.056)+(3.021), (I-655)+(1.056)+(3.022), (I-655)+(1.056)+(3.023), (I-655)+(1.056)+(3.024), (I-655)+(1.056)+(3.025), (I-655)+(1.056)+(3.026), (I-655)+(1.056)+(3.027), (I-655)+(1.056)+(3.028), (I-655)+(1.056)+(3.029), (I-655)+(1.056)+(3.030), (I-655)+(1.056)+(3.031), (I-655)+(1.056)+(5.001), (I-655)+(1.056)+(5.002), (I-655)+(1.056)+(5.003), (I-655)+(1.056)+(5.004), (I-655)+(1.056)+(5.005), (I-655)+(1.056)+(5.006), (I-655)+(1.056)+(5.007), (I-655)+(1.056)+(5.008), (I-655)+(1.056)+(5.009), (I-655)+(1.056)+(5.010), (I-655)+(1.056)+(5.011), (I-655)+(1.056)+(5.012), (I-655)+(1.056)+(5.013), (I-655)+(1.056)+(5.014), (I-655)+(1.056)+(5.015), (I-655)+(1.056)+(5.016), (I-655)+(1.056)+(5.017), (I-655)+(1.056)+(5.018), (I-655)+(1.056)+(5.019), (I-655)+(1.056)+(5.020), (I-655)+(1.056)+(5.021), (I-655)+(1.056)+(5.022), (I-655)+(1.056)+(5.023), (I-655)+(1.056)+(6.001), (I-655)+(1.056)+(6.002), (I-655)+(1.056)+(6.003), (I-655)+(1.056)+(6.004), (I-655)+(1.056)+(7.001), (I-655)+(1.056)+(7.002), (I-655)+(1.056)+(7.003), (I-655)+(1.056)+(7.004), (I-655)+(1.056)+(7.005), (I-655)+(1.056)+(7.006), (I-655)+(1.056)+(9.001), (I-655)+(1.056)+(9.002), (I-655)+(1.056)+(9.003), (I-655)+(1.056)+(9.004), (I-655)+(1.056)+(9.005), (I-655)+(1.056)+(9.006), (I-655)+(1.056)+(9.007), (I-655)+(1.056)+(9.008), (I-655)+(1.056)+(9.009), (I-655)+(1.056)+(14.001), (I-655)+(1.056)+(14.002), (I-655)+(1.056)+(15.008), (I-655)+(1.056)+(15.011), (I-655)+(1.056)+(15.012), (I-655)+(1.056)+(15.016), (I-655)+(1.056)+(15.025), (I-655)+(1.056)+(15.027), (I-655)+(1.056)+(15.047), (I-655)+(1.056)+(15.063), (I-655)+(1.056)+(15.064), (I-655)+(1.056)+(16.001), (I-655)+(1.056)+(16.002), (I-655)+(1.056)+(16.003), (I-655)+(1.056)+(16.004), (I-655)+(1.056)+(16.005), (I-655)+(1.056)+(16.006), (I-655)+(1.056)+(16.007), (I-655)+(1.056)+(16.008), (I-655)+(1.056)+(17.001), (I-655)+(1.056)+(17.002), (I-655)+(1.056)+(17.003), (I-655)+(1.056)+(17.004), (I-655)+(1.056)+(17.005), (I-655)+(1.056)+(17.006), (I-655)+(1.056)+(17.007), (I-655)+(1.056)+(17.008), (I-655)+(1.056)+(17.009), (I-655)+(1.056)+(17.010), (I-655)+(1.056)+(17.011), (I-655)+(1.056)+(17.012), (I-655)+(1.056)+(18.001),

(I-655)+(1.057)+(1.058), (I-655)+(1.057)+(1.059), (I-655)+(1.057)+(1.060), (I-655)+(1.057)+(1.061), (I-655)+(1.057)+(1.062), (I-655)+(1.057)+(1.063), (I-655)+(1.057)+(1.064), (I-655)+(1.057)+(1.065), (I-655)+(1.057)+(1.066), (I-655)+(1.057)+(1.067), (I-655)+(1.057)+(1.068), (I-655)+(1.057)+(1.069), (I-655)+(1.057)+(1.070), (I-655)+(1.057)+(1.071), (I-655)+(1.057)+(1.072), (I-655)+(1.057)+(1.073), (I-655)+(1.057)+(1.074), (I-655)+(1.057)+(1.075), (I-655)+(1.057)+(1.076), (I-655)+(1.057)+(1.077), (I-655)+(1.057)+(1.078), (I-655)+(1.057)+(1.079), (I-655)+(1.057)+(1.080), (I-655)+(1.057)+(1.081), (I-655)+(1.057)+(1.082), (I-655)+(1.057)+(1.083), (I-655)+(1.057)+(1.084), (I-655)+(1.057)+(1.085), (I-655)+(1.057)+(1.086), (I-655)+(1.057)+(1.087), (I-655)+(1.057)+(1.088), (I-655)+(1.057)+(1.089), (I-655)+(1.057)+(1.090), (I-655)+(1.057)+(1.091), (I-655)+(1.057)+(1.092), (I-655)+(1.057)+(2.001), (I-655)+(1.057)+(2.002), (I-655)+(1.057)+(2.003), (I-655)+(1.057)+(2.004), (I-655)+(1.057)+(2.005), (I-655)+(1.057)+(2.006), (I-655)+(1.057)+(2.007), (I-655)+(1.057)+(2.008), (I-655)+(1.057)+(2.009), (I-655)+(1.057)+(2.010), (I-655)+(1.057)+(2.011), (I-655)+(1.057)+(2.012), (I-655)+(1.057)+(2.013), (I-655)+(1.057)+(2.014), (I-655)+(1.057)+(2.015), (I-655)+(1.057)+(2.016), (I-655)+(1.057)+(2.017), (I-655)+(1.057)+(2.018), (I-655)+(1.057)+(2.019), (I-655)+(1.057)+(2.020), (I-655)+(1.057)+(2.021), (I-655)+(1.057)+(2.022), (I-655)+(1.057)+(2.023), (I-655)+(1.057)+(2.024), (I-655)+(1.057)+(2.025), (I-655)+(1.057)+(2.026), (I-655)+(1.057)+(2.027), (I-655)+(1.057)+(2.028), (I-655)+(1.057)+(2.029), (I-655)+(1.057)+(2.030), (I-655)+(1.057)+(2.031), (I-655)+(1.057)+(2.032), (I-655)+(1.057)+(2.033), (I-655)+(1.057)+(2.034), (I-655)+(1.057)+(2.035), (I-655)+(1.057)+(2.036), (I-655)+(1.057)+(2.037), (I-655)+(1.057)+(2.038), (I-655)+(1.057)+(2.039), (I-655)+(1.057)+(2.040), (I-655)+(1.057)+(2.041), (I-655)+(1.057)+(2.042), (I-655)+(1.057)+(2.043), (I-655)+(1.057)+(2.044), (I-655)+(1.057)+(2.045), (I-655)+(1.057)+(2.046), (I-655)+(1.057)+(2.047), (I-655)+(1.057)+(2.048), (I-655)+(1.057)+(2.049), (I-655)+(1.057)+(2.050), (I-655)+(1.057)+(2.051), (I-655)+(1.057)+(2.052), (I-655)+(1.057)+(2.053), (I-655)+(1.057)+(2.054), (I-655)+(1.057)+(2.055), (I-655)+(1.057)+(2.056), (I-655)+(1.057)+(2.057), (I-655)+(1.057)+(2.058), (I-655)+(1.057)+(2.059), (I-655)+(1.057)+(3.001), (I-655)+(1.057)+(3.002), (I-655)+(1.057)+(3.003), (I-655)+(1.057)+(3.004), (I-655)+(1.057)+(3.005), (I-655)+(1.057)+(3.006), (I-655)+(1.057)+(3.007), (I-655)+(1.057)+(3.008), (I-655)+(1.057)+(3.009), (I-655)+(1.057)+(3.010), (I-655)+(1.057)+(3.011), (I-655)+(1.057)+(3.012), (I-655)+(1.057)+(3.013), (I-655)+(1.057)+(3.014), (I-655)+(1.057)+(3.015), (I-655)+(1.057)+(3.016), (I-655)+(1.057)+(3.017), (I-655)+(1.057)+(3.018), (I-655)+(1.057)+(3.019), (I-655)+(1.057)+(3.020), (I-655)+(1.057)+(3.021), (I-655)+(1.057)+(3.022), (I-655)+(1.057)+(3.023), (I-655)+(1.057)+(3.024), (I-655)+(1.057)+(3.025), (I-655)+(1.057)+(3.026), (I-655)+(1.057)+(3.027), (I-655)+(1.057)+(3.028), (I-655)+(1.057)+(3.029), (I-655)+(1.057)+(3.030), (I-655)+(1.057)+(3.031), (I-655)+(1.057)+(5.001), (I-655)+(1.057)+(5.002), (I-655)+(1.057)+(5.003), (I-655)+(1.057)+(5.004), (I-655)+(1.057)+(5.005), (I-655)+(1.057)+(5.006), (I-655)+(1.057)+(5.007), (I-655)+(1.057)+(5.008), (I-655)+(1.057)+(5.009), (I-655)+(1.057)+(5.010), (I-655)+(1.057)+(5.011), (I-655)+(1.057)+(5.012), (I-655)+(1.057)+(5.013), (I-655)+(1.057)+(5.014), (I-655)+(1.057)+(5.015), (I-655)+(1.057)+(5.016), (I-655)+(1.057)+(5.017), (I-655)+(1.057)+(5.018), (I-655)+(1.057)+(5.019), (I-655)+(1.057)+(5.020), (I-655)+(1.057)+(5.021), (I-655)+(1.057)+(5.022), (I-655)+(1.057)+(5.023), (I-655)+(1.057)+(6.001), (I-655)+(1.057)+(6.002), (I-655)+(1.057)+(6.003), (I-655)+(1.057)+(6.004), (I-655)+(1.057)+(7.001), (I-655)+(1.057)+(7.002), (I-655)+(1.057)+(7.003), (I-655)+(1.057)+(7.004), (I-655)+(1.057)+(7.005), (I-655)+(1.057)+(7.006), (I-655)+(1.057)+(9.001), (I-655)+(1.057)+(9.002), (I-655)+(1.057)+(9.003), (I-655)+(1.057)+(9.004), (I-655)+(1.057)+(9.005), (I-655)+(1.057)+(9.006), (I-655)+(1.057)+(9.007), (I-655)+(1.057)+(9.008), (I-655)+(1.057)+(9.009), (I-655)+(1.057)+(14.001), (I-655)+(1.057)+(14.002), (I-655)+(1.057)+(15.008), (I-655)+(1.057)+(15.011), (I-655)+(1.057)+(15.012), (I-655)+(1.057)+(15.016), (I-655)+(1.057)+(15.025), (I-655)+(1.057)+(15.027), (I-655)+(1.057)+(15.047), (I-655)+(1.057)+(15.063), (I-655)+(1.057)+(15.064), (I-655)+(1.057)+(16.001), (I-655)+(1.057)+(16.002), (I-655)+(1.057)+(16.003), (I-655)+(1.057)+(16.004), (I-655)+(1.057)+(16.005), (I-655)+(1.057)+(16.006), (I-655)+(1.057)+(16.007), (I-655)+(1.057)+(16.008), (I-655)+(1.057)+(17.001), (I-655)+(1.057)+(17.002), (I-655)+(1.057)+(17.003), (I-655)+(1.057)+(17.004), (I-655)+(1.057)+(17.005), (I-655)+(1.057)+(17.006), (I-655)+(1.057)+(17.007), (I-655)+(1.057)+(17.008), (I-655)+(1.057)+(17.009), (I-655)+(1.057)+(17.010), (I-655)+(1.057)+(17.011), (I-655)+(1.057)+(17.012), (I-655)+(1.057)+(18.001),

(I-655)+(1.058)+(1.059), (I-655)+(1.058)+(1.060), (I-655)+(1.058)+(1.061), (I-655)+(1.058)+(1.062), (I-655)+(1.058)+(1.063), (I-655)+(1.058)+(1.064), (I-655)+(1.058)+(1.065), (I-655)+(1.058)+(1.066), (I-655)+(1.058)+(1.067), (I-655)+(1.058)+(1.068), (I-655)+(1.058)+(1.069), (I-655)+(1.058)+(1.070), (I-655)+(1.058)+(1.071), (I-655)+(1.058)+(1.072), (I-655)+(1.058)+(1.073), (I-655)+(1.058)+(1.074), (I-655)+(1.058)+(1.075), (I-655)+(1.058)+(1.076), (I-655)+(1.058)+(1.077), (I-655)+(1.058)+(1.078), (I-655)+(1.058)+(1.079), (I-655)+(1.058)+(1.080), (I-655)+(1.058)+(1.081), (I-655)+(1.058)+(1.082), (I-655)+(1.058)+(1.083), (I-655)+(1.058)+(1.084), (I-655)+(1.058)+(1.085), (I-655)+(1.058)+(1.086), (I-655)+(1.058)+(1.087), (I-655)+(1.058)+(1.088), (I-655)+(1.058)+(1.089), (I-655)+(1.058)+(1.090), (I-655)+(1.058)+(1.091), (I-655)+(1.058)+(1.092), (I-655)+(1.058)+(2.001), (I-655)+(1.058)+(2.002), (I-655)+(1.058)+(2.003), (I-655)+(1.058)+(2.004), (I-655)+(1.058)+(2.005), (I-655)+(1.058)+(2.006), (I-655)+(1.058)+(2.007), (I-655)+(1.058)+(2.008), (I-655)+(1.058)+(2.009), (I-655)+(1.058)+(2.010), (I-655)+(1.058)+(2.011), (I-655)+(1.058)+(2.012), (I-655)+(1.058)+(2.013), (I-655)+(1.058)+(2.014), (I-655)+(1.058)+(2.015), (I-655)+(1.058)+(2.016), (I-655)+(1.058)+(2.017), (I-655)+(1.058)+(2.018), (I-655)+(1.058)+(2.019), (I-655)+(1.058)+(2.020), (I-655)+(1.058)+(2.021), (I-655)+(1.058)+(2.022), (I-655)+(1.058)+(2.023), (I-655)+(1.058)+(2.024), (I-655)+(1.058)+(2.025), (I-655)+(1.058)+(2.026), (I-655)+(1.058)+(2.027), (I-655)+(1.058)+(2.028), (I-655)+(1.058)+(2.029), (I-655)+(1.058)+(2.030), (I-655)+(1.058)+(2.031), (I-655)+(1.058)+(2.032), (I-655)+(1.058)+(2.033), (I-655)+(1.058)+(2.034), (I-655)+(1.058)+(2.035), (I-655)+(1.058)+(2.036), (I-655)+(1.058)+(2.037), (I-655)+(1.058)+(2.038), (I-655)+(1.058)+(2.039), (I-655)+(1.058)+(2.040), (I-655)+(1.058)+(2.041), (I-655)+(1.058)+(2.042), (I-655)+(1.058)+(2.043), (I-655)+(1.058)+(2.044), (I-655)+(1.058)+(2.045), (I-655)+(1.058)+(2.046), (I-655)+(1.058)+(2.047), (I-655)+(1.058)+(2.048), (I-655)+(1.058)+(2.049), (I-655)+(1.058)+(2.050), (I-655)+(1.058)+(2.051), (I-655)+(1.058)+(2.052), (I-655)+(1.058)+(2.053), (I-655)+(1.058)+(2.054), (I-655)+(1.058)+(2.055), (I-655)+(1.058)+(2.056), (I-655)+(1.058)+(2.057), (I-655)+(1.058)+(2.058), (I-655)+(1.058)+(2.059), (I-655)+(1.058)+(3.001), (I-655)+(1.058)+(3.002), (I-655)+(1.058)+(3.003), (I-655)+(1.058)+(3.004), (I-655)+(1.058)+(3.005), (I-655)+(1.058)+(3.006), (I-655)+(1.058)+(3.007), (I-655)+(1.058)+(3.008), (I-655)+(1.058)+(3.009), (I-655)+(1.058)+(3.010), (I-655)+(1.058)+(3.011), (I-655)+(1.058)+(3.012), (I-655)+(1.058)+(3.013), (I-655)+(1.058)+(3.014), (I-655)+(1.058)+(3.015), (I-655)+(1.058)+(3.016), (I-655)+(1.058)+(3.017), (I-655)+(1.058)+(3.018), (I-655)+(1.058)+(3.019), (I-655)+(1.058)+(3.020), (I-655)+(1.058)+(3.021), (I-655)+(1.058)+(3.022), (I-655)+(1.058)+(3.023), (I-655)+(1.058)+(3.024), (I-655)+(1.058)+(3.025), (I-655)+(1.058)+(3.026), (I-655)+(1.058)+(3.027), (I-655)+(1.058)+(3.028), (I-655)+(1.058)+(3.029), (I-655)+(1.058)+(3.030), (I-655)+(1.058)+(3.031), (I-655)+(1.058)+(5.001), (I-655)+(1.058)+(5.002), (I-655)+(1.058)+(5.003), (I-655)+(1.058)+(5.004), (I-655)+(1.058)+(5.005), (I-655)+(1.058)+(5.006), (I-655)+(1.058)+(5.007), (I-655)+(1.058)+(5.008), (I-655)+(1.058)+(5.009), (I-655)+(1.058)+(5.010), (I-655)+(1.058)+(5.011), (I-655)+(1.058)+(5.012), (I-655)+(1.058)+(5.013), (I-655)+(1.058)+(5.014), (I-655)+(1.058)+(5.015), (I-655)+(1.058)+(5.016), (I-655)+(1.058)+(5.017), (I-655)+(1.058)+(5.018), (I-655)+(1.058)+(5.019), (I-655)+(1.058)+(5.020), (I-655)+(1.058)+(5.021), (I-655)+(1.058)+(5.022), (I-655)+(1.058)+(5.023), (I-655)+(1.058)+(6.001), (I-655)+(1.058)+(6.002), (I-655)+(1.058)+(6.003), (I-655)+(1.058)+(6.004), (I-655)+(1.058)+(7.001), (I-655)+(1.058)+(7.002), (I-655)+(1.058)+(7.003), (I-655)+(1.058)+(7.004), (I-655)+(1.058)+(7.005), (I-655)+(1.058)+(7.006), (I-655)+(1.058)+(9.001), (I-655)+(1.058)+(9.002), (I-655)+(1.058)+(9.003), (I-655)+(1.058)+(9.004), (I-655)+(1.058)+(9.005), (I-655)+(1.058)+(9.006), (I-655)+(1.058)+(9.007), (I-655)+(1.058)+(9.008), (I-655)+(1.058)+(9.009), (I-655)+(1.058)+(14.001), (I-655)+(1.058)+(14.002), (I-655)+(1.058)+(15.008), (I-655)+(1.058)+(15.011), (I-655)+(1.058)+(15.012), (I-655)+(1.058)+(15.016), (I-655)+(1.058)+(15.025), (I-655)+(1.058)+(15.027), (I-655)+(1.058)+(15.047), (I-655)+(1.058)+(15.063), (I-655)+(1.058)+(15.064), (I-655)+(1.058)+(16.001), (I-655)+(1.058)+(16.002), (I-655)+(1.058)+(16.003), (I-655)+(1.058)+(16.004), (I-655)+(1.058)+(16.005), (I-655)+(1.058)+(16.006), (I-655)+(1.058)+(16.007), (I-655)+(1.058)+(16.008), (I-655)+(1.058)+(17.001), (I-655)+(1.058)+(17.002), (I-655)+(1.058)+(17.003), (I-655)+(1.058)+(17.004), (I-655)+(1.058)+(17.005), (I-655)+(1.058)+(17.006), (I-655)+(1.058)+(17.007), (I-655)+(1.058)+(17.008), (I-655)+(1.058)+(17.009), (I-655)+(1.058)+(17.010), (I-655)+(1.058)+(17.011), (I-655)+(1.058)+(17.012), (I-655)+(1.058)+(18.001),

(I-655)+(1.059)+(1.060), (I-655)+(1.059)+(1.061), (I-655)+(1.059)+(1.062), (I-655)+(1.059)+(1.063), (I-655)+(1.059)+(1.064), (I-655)+(1.059)+(1.065), (I-655)+(1.059)+(1.066), (I-655)+(1.059)+(1.067), (I-655)+(1.059)+(1.068), (I-655)+(1.059)+(1.069), (I-655)+(1.059)+(1.070), (I-655)+(1.059)+(1.071), (I-655)+(1.059)+(1.072), (I-655)+(1.059)+(1.073), (I-655)+(1.059)+(1.074), (I-655)+(1.059)+(1.075), (I-655)+(1.059)+(1.076), (I-655)+(1.059)+(1.077), (I-655)+(1.059)+(1.078), (I-655)+(1.059)+(1.079), (I-655)+(1.059)+(1.080), (I-655)+(1.059)+(1.081), (I-655)+(1.059)+(1.082), (I-655)+(1.059)+(1.083), (I-655)+(1.059)+(1.084), (I-655)+(1.059)+(1.085), (I-655)+(1.059)+(1.086), (I-655)+(1.059)+(1.087), (I-655)+(1.059)+(1.088), (I-655)+(1.059)+(1.089), (I-655)+(1.059)+(1.090), (I-655)+(1.059)+(1.091), (I-655)+(1.059)+(1.092), (I-655)+(1.059)+(2.001), (I-655)+(1.059)+(2.002), (I-655)+(1.059)+(2.003), (I-655)+(1.059)+(2.004), (I-655)+(1.059)+(2.005), (I-655)+(1.059)+(2.006), (I-655)+(1.059)+(2.007), (I-655)+(1.059)+(2.008), (I-655)+(1.059)+(2.009), (I-655)+(1.059)+(2.010), (I-655)+(1.059)+(2.011), (I-655)+(1.059)+(2.012), (I-655)+(1.059)+(2.013), (I-655)+(1.059)+(2.014), (I-655)+(1.059)+(2.015), (I-655)+(1.059)+(2.016), (I-655)+(1.059)+(2.017), (I-655)+(1.059)+(2.018), (I-655)+(1.059)+(2.019), (I-655)+(1.059)+(2.020), (I-655)+(1.059)+(2.021), (I-655)+(1.059)+(2.022), (I-655)+(1.059)+(2.023), (I-655)+(1.059)+(2.024), (I-655)+(1.059)+(2.025), (I-655)+(1.059)+(2.026), (I-655)+(1.059)+(2.027), (I-655)+(1.059)+(2.028), (I-655)+(1.059)+(2.029), (I-655)+(1.059)+(2.030), (I-655)+(1.059)+(2.031), (I-655)+(1.059)+(2.032), (I-655)+(1.059)+(2.033), (I-655)+(1.059)+(2.034), (I-655)+(1.059)+(2.035), (I-655)+(1.059)+(2.036), (I-655)+(1.059)+(2.037), (I-655)+(1.059)+(2.038), (I-655)+(1.059)+(2.039), (I-655)+(1.059)+(2.040), (I-655)+(1.059)+(2.041), (I-655)+(1.059)+(2.042), (I-655)+(1.059)+(2.043), (I-655)+(1.059)+(2.044), (I-655)+(1.059)+(2.045), (I-655)+(1.059)+(2.046), (I-655)+(1.059)+(2.047), (I-655)+(1.059)+(2.048), (I-655)+(1.059)+(2.049), (I-655)+(1.059)+(2.050), (I-655)+(1.059)+(2.051), (I-655)+(1.059)+(2.052), (I-655)+(1.059)+(2.053), (I-655)+(1.059)+(2.054), (I-655)+(1.059)+(2.055), (I-655)+(1.059)+(2.056), (I-655)+(1.059)+(2.057), (I-655)+(1.059)+(2.058), (I-655)+(1.059)+(2.059), (I-655)+(1.059)+(3.001), (I-655)+(1.059)+(3.002), (I-655)+(1.059)+(3.003), (I-655)+(1.059)+(3.004), (I-655)+(1.059)+(3.005), (I-655)+(1.059)+(3.006), (I-655)+(1.059)+(3.007), (I-655)+(1.059)+(3.008), (I-655)+(1.059)+(3.009), (I-655)+(1.059)+(3.010), (I-655)+(1.059)+(3.011), (I-655)+(1.059)+(3.012), (I-655)+(1.059)+(3.013), (I-655)+(1.059)+(3.014), (I-655)+(1.059)+(3.015), (I-655)+(1.059)+(3.016), (I-655)+(1.059)+(3.017), (I-655)+(1.059)+(3.018), (I-655)+(1.059)+(3.019), (I-655)+(1.059)+(3.020), (I-655)+(1.059)+(3.021), (I-655)+(1.059)+(3.022), (I-655)+(1.059)+(3.023), (I-655)+(1.059)+(3.024), (I-655)+(1.059)+(3.025), (I-655)+(1.059)+(3.026), (I-655)+(1.059)+(3.027), (I-655)+(1.059)+(3.028), (I-655)+(1.059)+(3.029), (I-655)+(1.059)+(3.030), (I-655)+(1.059)+(3.031), (I-655)+(1.059)+(5.001), (I-655)+(1.059)+(5.002), (I-655)+(1.059)+(5.003), (I-655)+(1.059)+(5.004), (I-655)+(1.059)+(5.005), (I-655)+(1.059)+(5.006), (I-655)+(1.059)+(5.007), (I-655)+(1.059)+(5.008), (I-655)+(1.059)+(5.009), (I-655)+(1.059)+(5.010), (I-655)+(1.059)+(5.011), (I-655)+(1.059)+(5.012), (I-655)+(1.059)+(5.013), (I-655)+(1.059)+(5.014), (I-655)+(1.059)+(5.015), (I-655)+(1.059)+(5.016), (I-655)+(1.059)+(5.017), (I-655)+(1.059)+(5.018), (I-655)+(1.059)+(5.019), (I-655)+(1.059)+(5.020), (I-655)+(1.059)+(5.021), (I-655)+(1.059)+(5.022), (I-655)+(1.059)+(5.023), (I-655)+(1.059)+(6.001), (I-655)+(1.059)+(6.002), (I-655)+(1.059)+(6.003), (I-655)+(1.059)+(6.004), (I-655)+(1.059)+(7.001), (I-655)+(1.059)+(7.002), (I-655)+(1.059)+(7.003), (I-655)+(1.059)+(7.004), (I-655)+(1.059)+(7.005), (I-655)+(1.059)+(7.006), (I-655)+(1.059)+(9.001), (I-655)+(1.059)+(9.002), (I-655)+(1.059)+(9.003), (I-655)+(1.059)+(9.004), (I-655)+(1.059)+(9.005), (I-655)+(1.059)+(9.006), (I-655)+(1.059)+(9.007), (I-655)+(1.059)+(9.008), (I-655)+(1.059)+(9.009), (I-655)+(1.059)+(14.001), (I-655)+(1.059)+(14.002), (I-655)+(1.059)+(15.008), (I-655)+(1.059)+(15.011), (I-655)+(1.059)+(15.012), (I-655)+(1.059)+(15.016), (I-655)+(1.059)+(15.025), (I-655)+(1.059)+(15.027), (I-655)+(1.059)+(15.047), (I-655)+(1.059)+(15.063), (I-655)+(1.059)+(15.064), (I-655)+(1.059)+(16.001), (I-655)+(1.059)+(16.002), (I-655)+(1.059)+(16.003), (I-655)+(1.059)+(16.004), (I-655)+(1.059)+(16.005), (I-655)+(1.059)+(16.006), (I-655)+(1.059)+(16.007), (I-655)+(1.059)+(16.008), (I-655)+(1.059)+(17.001), (I-655)+(1.059)+(17.002), (I-655)+(1.059)+(17.003), (I-655)+(1.059)+(17.004), (I-655)+(1.059)+(17.005), (I-655)+(1.059)+(17.006), (I-655)+(1.059)+(17.007), (I-655)+(1.059)+(17.008), (I-655)+(1.059)+(17.009), (I-655)+(1.059)+(17.010), (I-655)+(1.059)+(17.011), (I-655)+(1.059)+(17.012), (I-655)+(1.059)+(18.001),

(I-655)+(1.060)+(1.061), (I-655)+(1.060)+(1.062), (I-655)+(1.060)+(1.063), (I-655)+(1.060)+(1.064), (I-655)+(1.060)+(1.065), (I-655)+(1.060)+(1.066), (I-655)+(1.060)+(1.067), (I-655)+(1.060)+(1.068), (I-655)+(1.060)+(1.069), (I-655)+(1.060)+(1.070), (I-655)+(1.060)+(1.071), (I-655)+(1.060)+(1.072), (I-655)+(1.060)+(1.073), (I-655)+(1.060)+(1.074), (I-655)+(1.060)+(1.075), (I-655)+(1.060)+(1.076), (I-655)+(1.060)+(1.077), (I-655)+(1.060)+(1.078), (I-655)+(1.060)+(1.079), (I-655)+(1.060)+(1.080), (I-655)+(1.060)+(1.081), (I-655)+(1.060)+(1.082), (I-655)+(1.060)+(1.083), (I-655)+(1.060)+(1.084), (I-655)+(1.060)+(1.085), (I-655)+(1.060)+(1.086), (I-655)+(1.060)+(1.087), (I-655)+(1.060)+(1.088), (I-655)+(1.060)+(1.089), (I-655)+(1.060)+(1.090), (I-655)+(1.060)+(1.091), (I-655)+(1.060)+(1.092), (I-655)+(1.060)+(2.001), (I-655)+(1.060)+(2.002), (I-655)+(1.060)+(2.003), (I-655)+(1.060)+(2.004), (I-655)+(1.060)+(2.005), (I-655)+(1.060)+(2.006), (I-655)+(1.060)+(2.007), (I-655)+(1.060)+(2.008), (I-655)+(1.060)+(2.009), (I-655)+(1.060)+(2.010), (I-655)+(1.060)+(2.011), (I-655)+(1.060)+(2.012), (I-655)+(1.060)+(2.013), (I-655)+(1.060)+(2.014), (I-655)+(1.060)+(2.015), (I-655)+(1.060)+(2.016), (I-655)+(1.060)+(2.017), (I-655)+(1.060)+(2.018), (I-655)+(1.060)+(2.019), (I-655)+(1.060)+(2.020), (I-655)+(1.060)+(2.021), (I-655)+(1.060)+(2.022), (I-655)+(1.060)+(2.023), (I-655)+(1.060)+(2.024), (I-655)+(1.060)+(2.025), (I-655)+(1.060)+(2.026), (I-655)+(1.060)+(2.027), (I-655)+(1.060)+(2.028), (I-655)+(1.060)+(2.029), (I-655)+(1.060)+(2.030), (I-655)+(1.060)+(2.031), (I-655)+(1.060)+(2.032), (I-655)+(1.060)+(2.033), (I-655)+(1.060)+(2.034), (I-655)+(1.060)+(2.035), (I-655)+(1.060)+(2.036), (I-655)+(1.060)+(2.037), (I-655)+(1.060)+(2.038), (I-655)+(1.060)+(2.039), (I-655)+(1.060)+(2.040), (I-655)+(1.060)+(2.041), (I-655)+(1.060)+(2.042), (I-655)+(1.060)+(2.043), (I-655)+(1.060)+(2.044), (I-655)+(1.060)+(2.045), (I-655)+(1.060)+(2.046), (I-655)+(1.060)+(2.047), (I-655)+(1.060)+(2.048), (I-655)+(1.060)+(2.049), (I-655)+(1.060)+(2.050), (I-655)+(1.060)+(2.051), (I-655)+(1.060)+(2.052), (I-655)+(1.060)+(2.053), (I-655)+(1.060)+(2.054), (I-655)+(1.060)+(2.055), (I-655)+(1.060)+(2.056), (I-655)+(1.060)+(2.057), (I-655)+(1.060)+(2.058), (I-655)+(1.060)+(2.059), (I-655)+(1.060)+(3.001), (I-655)+(1.060)+(3.002), (I-655)+(1.060)+(3.003), (I-655)+(1.060)+(3.004), (I-655)+(1.060)+(3.005), (I-655)+(1.060)+(3.006), (I-655)+(1.060)+(3.007), (I-655)+(1.060)+(3.008), (I-655)+(1.060)+(3.009), (I-655)+(1.060)+(3.010), (I-655)+(1.060)+(3.011), (I-655)+(1.060)+(3.012), (I-655)+(1.060)+(3.013), (I-655)+(1.060)+(3.014), (I-655)+(1.060)+(3.015), (I-655)+(1.060)+(3.016), (I-655)+(1.060)+(3.017), (I-655)+(1.060)+(3.018), (I-655)+(1.060)+(3.019), (I-655)+(1.060)+(3.020), (I-655)+(1.060)+(3.021), (I-655)+(1.060)+(3.022), (I-655)+(1.060)+(3.023), (I-655)+(1.060)+(3.024), (I-655)+(1.060)+(3.025), (I-655)+(1.060)+(3.026), (I-655)+(1.060)+(3.027), (I-655)+(1.060)+(3.028), (I-655)+(1.060)+(3.029), (I-655)+(1.060)+(3.030), (I-655)+(1.060)+(3.031), (I-655)+(1.060)+(5.001), (I-655)+(1.060)+(5.002), (I-655)+(1.060)+(5.003), (I-655)+(1.060)+(5.004), (I-655)+(1.060)+(5.005), (I-655)+(1.060)+(5.006), (I-655)+(1.060)+(5.007), (I-655)+(1.060)+(5.008), (I-655)+(1.060)+(5.009), (I-655)+(1.060)+(5.010), (I-655)+(1.060)+(5.011), (I-655)+(1.060)+(5.012), (I-655)+(1.060)+(5.013), (I-655)+(1.060)+(5.014), (I-655)+(1.060)+(5.015), (I-655)+(1.060)+(5.016), (I-655)+(1.060)+(5.017), (I-655)+(1.060)+(5.018), (I-655)+(1.060)+(5.019), (I-655)+(1.060)+(5.020), (I-655)+(1.060)+(5.021), (I-655)+(1.060)+(5.022), (I-655)+(1.060)+(5.023), (I-655)+(1.060)+(6.001), (I-655)+(1.060)+(6.002), (I-655)+(1.060)+(6.003), (I-655)+(1.060)+(6.004), (I-655)+(1.060)+(7.001), (I-655)+(1.060)+(7.002), (I-655)+(1.060)+(7.003), (I-655)+(1.060)+(7.004), (I-655)+(1.060)+(7.005), (I-655)+(1.060)+(7.006), (I-655)+(1.060)+(9.001), (I-655)+(1.060)+(9.002), (I-655)+(1.060)+(9.003), (I-655)+(1.060)+(9.004), (I-655)+(1.060)+(9.005), (I-655)+(1.060)+(9.006), (I-655)+(1.060)+(9.007), (I-655)+(1.060)+(9.008), (I-655)+(1.060)+(9.009), (I-655)+(1.060)+(14.001), (I-655)+(1.060)+(14.002), (I-655)+(1.060)+(15.008), (I-655)+(1.060)+(15.011), (I-655)+(1.060)+(15.012), (I-655)+(1.060)+(15.016), (I-655)+(1.060)+(15.025), (I-655)+(1.060)+(15.027), (I-655)+(1.060)+(15.047), (I-655)+(1.060)+(15.063), (I-655)+(1.060)+(15.064), (I-655)+(1.060)+(16.001), (I-655)+(1.060)+(16.002), (I-655)+(1.060)+(16.003), (I-655)+(1.060)+(16.004), (I-655)+(1.060)+(16.005), (I-655)+(1.060)+(16.006), (I-655)+(1.060)+(16.007), (I-655)+(1.060)+(16.008), (I-655)+(1.060)+(17.001), (I-655)+(1.060)+(17.002), (I-655)+(1.060)+(17.003), (I-655)+(1.060)+(17.004), (I-655)+(1.060)+(17.005), (I-655)+(1.060)+(17.006), (I-655)+(1.060)+(17.007), (I-655)+(1.060)+(17.008), (I-655)+(1.060)+(17.009), (I-655)+(1.060)+(17.010), (I-655)+(1.060)+(17.011), (I-655)+(1.060)+(17.012), (I-655)+(1.060)+(18.001),

(I-655)+(1.061)+(1.062), (I-655)+(1.061)+(1.063), (I-655)+(1.061)+(1.064), (I-655)+(1.061)+(1.065), (I-655)+(1.061)+(1.066), (I-655)+(1.061)+(1.067), (I-655)+(1.061)+(1.068), (I-655)+(1.061)+(1.069), (I-655)+(1.061)+(1.070), (I-655)+(1.061)+(1.071), (I-655)+(1.061)+(1.072), (I-655)+(1.061)+(1.073), (I-655)+(1.061)+(1.074), (I-655)+(1.061)+(1.075), (I-655)+(1.061)+(1.076), (I-655)+(1.061)+(1.077), (I-655)+(1.061)+(1.078), (I-655)+(1.061)+(1.079), (I-655)+(1.061)+(1.080), (I-655)+(1.061)+(1.081), (I-655)+(1.061)+(1.082), (I-655)+(1.061)+(1.083), (I-655)+(1.061)+(1.084), (I-655)+(1.061)+(1.085), (I-655)+(1.061)+(1.086), (I-655)+(1.061)+(1.087), (I-655)+(1.061)+(1.088), (I-655)+(1.061)+(1.089), (I-655)+(1.061)+(1.090), (I-655)+(1.061)+(1.091), (I-655)+(1.061)+(1.092), (I-655)+(1.061)+(2.001), (I-655)+(1.061)+(2.002), (I-655)+(1.061)+(2.003), (I-655)+(1.061)+(2.004), (I-655)+(1.061)+(2.005), (I-655)+(1.061)+(2.006), (I-655)+(1.061)+(2.007), (I-655)+(1.061)+(2.008), (I-655)+(1.061)+(2.009), (I-655)+(1.061)+(2.010), (I-655)+(1.061)+(2.011), (I-655)+(1.061)+(2.012), (I-655)+(1.061)+(2.013), (I-655)+(1.061)+(2.014), (I-655)+(1.061)+(2.015), (I-655)+(1.061)+(2.016), (I-655)+(1.061)+(2.017), (I-655)+(1.061)+(2.018), (I-655)+(1.061)+(2.019), (I-655)+(1.061)+(2.020), (I-655)+(1.061)+(2.021), (I-655)+(1.061)+(2.022), (I-655)+(1.061)+(2.023), (I-655)+(1.061)+(2.024), (I-655)+(1.061)+(2.025), (I-655)+(1.061)+(2.026), (I-655)+(1.061)+(2.027), (I-655)+(1.061)+(2.028), (I-655)+(1.061)+(2.029), (I-655)+(1.061)+(2.030), (I-655)+(1.061)+(2.031), (I-655)+(1.061)+(2.032), (I-655)+(1.061)+(2.033), (I-655)+(1.061)+(2.034), (I-655)+(1.061)+(2.035), (I-655)+(1.061)+(2.036), (I-655)+(1.061)+(2.037), (I-655)+(1.061)+(2.038), (I-655)+(1.061)+(2.039), (I-655)+(1.061)+(2.040), (I-655)+(1.061)+(2.041), (I-655)+(1.061)+(2.042), (I-655)+(1.061)+(2.043), (I-655)+(1.061)+(2.044), (I-655)+(1.061)+(2.045), (I-655)+(1.061)+(2.046), (I-655)+(1.061)+(2.047), (I-655)+(1.061)+(2.048), (I-655)+(1.061)+(2.049), (I-655)+(1.061)+(2.050), (I-655)+(1.061)+(2.051), (I-655)+(1.061)+(2.052), (I-655)+(1.061)+(2.053), (I-655)+(1.061)+(2.054), (I-655)+(1.061)+(2.055), (I-655)+(1.061)+(2.056), (I-655)+(1.061)+(2.057), (I-655)+(1.061)+(2.058), (I-655)+(1.061)+(2.059), (I-655)+(1.061)+(3.001), (I-655)+(1.061)+(3.002), (I-655)+(1.061)+(3.003), (I-655)+(1.061)+(3.004), (I-655)+(1.061)+(3.005), (I-655)+(1.061)+(3.006), (I-655)+(1.061)+(3.007), (I-655)+(1.061)+(3.008), (I-655)+(1.061)+(3.009), (I-655)+(1.061)+(3.010), (I-655)+(1.061)+(3.011), (I-655)+(1.061)+(3.012), (I-655)+(1.061)+(3.013), (I-655)+(1.061)+(3.014), (I-655)+(1.061)+(3.015), (I-655)+(1.061)+(3.016), (I-655)+(1.061)+(3.017), (I-655)+(1.061)+(3.018), (I-655)+(1.061)+(3.019), (I-655)+(1.061)+(3.020), (I-655)+(1.061)+(3.021), (I-655)+(1.061)+(3.022), (I-655)+(1.061)+(3.023), (I-655)+(1.061)+(3.024), (I-655)+(1.061)+(3.025), (I-655)+(1.061)+(3.026), (I-655)+(1.061)+(3.027), (I-655)+(1.061)+(3.028), (I-655)+(1.061)+(3.029), (I-655)+(1.061)+(3.030), (I-655)+(1.061)+(3.031), (I-655)+(1.061)+(5.001), (I-655)+(1.061)+(5.002), (I-655)+(1.061)+(5.003), (I-655)+(1.061)+(5.004), (I-655)+(1.061)+(5.005), (I-655)+(1.061)+(5.006), (I-655)+(1.061)+(5.007), (I-655)+(1.061)+(5.008), (I-655)+(1.061)+(5.009), (I-655)+(1.061)+(5.010), (I-655)+(1.061)+(5.011), (I-655)+(1.061)+(5.012), (I-655)+(1.061)+(5.013), (I-655)+(1.061)+(5.014), (I-655)+(1.061)+(5.015), (I-655)+(1.061)+(5.016), (I-655)+(1.061)+(5.017), (I-655)+(1.061)+(5.018), (I-655)+(1.061)+(5.019), (I-655)+(1.061)+(5.020), (I-655)+(1.061)+(5.021), (I-655)+(1.061)+(5.022), (I-655)+(1.061)+(5.023), (I-655)+(1.061)+(6.001), (I-655)+(1.061)+(6.002), (I-655)+(1.061)+(6.003), (I-655)+(1.061)+(6.004), (I-655)+(1.061)+(7.001), (I-655)+(1.061)+(7.002), (I-655)+(1.061)+(7.003), (I-655)+(1.061)+(7.004), (I-655)+(1.061)+(7.005), (I-655)+(1.061)+(7.006), (I-655)+(1.061)+(9.001), (I-655)+(1.061)+(9.002), (I-655)+(1.061)+(9.003), (I-655)+(1.061)+(9.004), (I-655)+(1.061)+(9.005), (I-655)+(1.061)+(9.006), (I-655)+(1.061)+(9.007), (I-655)+(1.061)+(9.008), (I-655)+(1.061)+(9.009), (I-655)+(1.061)+(14.001), (I-655)+(1.061)+(14.002), (I-655)+(1.061)+(15.008), (I-655)+(1.061)+(15.011), (I-655)+(1.061)+(15.012), (I-655)+(1.061)+(15.016), (I-655)+(1.061)+(15.025), (I-655)+(1.061)+(15.027), (I-655)+(1.061)+(15.047), (I-655)+(1.061)+(15.063), (I-655)+(1.061)+(15.064), (I-655)+(1.061)+(16.001), (I-655)+(1.061)+(16.002), (I-655)+(1.061)+(16.003), (I-655)+(1.061)+(16.004), (I-655)+(1.061)+(16.005), (I-655)+(1.061)+(16.006), (I-655)+(1.061)+(16.007), (I-655)+(1.061)+(16.008), (I-655)+(1.061)+(17.001), (I-655)+(1.061)+(17.002), (I-655)+(1.061)+(17.003), (I-655)+(1.061)+(17.004), (I-655)+(1.061)+(17.005), (I-655)+(1.061)+(17.006), (I-655)+(1.061)+(17.007), (I-655)+(1.061)+(17.008), (I-655)+(1.061)+(17.009), (I-655)+(1.061)+(17.010), (I-655)+(1.061)+(17.011), (I-655)+(1.061)+(17.012), (I-655)+(1.061)+(18.001),

(I-655)+(1.062)+(1.063), (I-655)+(1.062)+(1.064), (I-655)+(1.062)+(1.065), (I-655)+(1.062)+(1.066), (I-655)+(1.062)+(1.067), (I-655)+(1.062)+(1.068), (I-655)+(1.062)+(1.069), (I-655)+(1.062)+(1.070), (I-655)+(1.062)+(1.071), (I-655)+(1.062)+(1.072), (I-655)+(1.062)+(1.073), (I-655)+(1.062)+(1.074), (I-655)+(1.062)+(1.075), (I-655)+(1.062)+(1.076), (I-655)+(1.062)+(1.077), (I-655)+(1.062)+(1.078), (I-655)+(1.062)+(1.079), (I-655)+(1.062)+(1.080), (I-655)+(1.062)+(1.081), (I-655)+(1.062)+(1.082), (I-655)+(1.062)+(1.083), (I-655)+(1.062)+(1.084), (I-655)+(1.062)+(1.085), (I-655)+(1.062)+(1.086), (I-655)+(1.062)+(1.087), (I-655)+(1.062)+(1.088), (I-655)+(1.062)+(1.089), (I-655)+(1.062)+(1.090), (I-655)+(1.062)+(1.091), (I-655)+(1.062)+(1.092), (I-655)+(1.062)+(2.001), (I-655)+(1.062)+(2.002), (I-655)+(1.062)+(2.003), (I-655)+(1.062)+(2.004), (I-655)+(1.062)+(2.005), (I-655)+(1.062)+(2.006), (I-655)+(1.062)+(2.007), (I-655)+(1.062)+(2.008), (I-655)+(1.062)+(2.009), (I-655)+(1.062)+(2.010), (I-655)+(1.062)+(2.011), (I-655)+(1.062)+(2.012), (I-655)+(1.062)+(2.013), (I-655)+(1.062)+(2.014), (I-655)+(1.062)+(2.015), (I-655)+(1.062)+(2.016), (I-655)+(1.062)+(2.017), (I-655)+(1.062)+(2.018), (I-655)+(1.062)+(2.019), (I-655)+(1.062)+(2.020), (I-655)+(1.062)+(2.021), (I-655)+(1.062)+(2.022), (I-655)+(1.062)+(2.023), (I-655)+(1.062)+(2.024), (I-655)+(1.062)+(2.025), (I-655)+(1.062)+(2.026), (I-655)+(1.062)+(2.027), (I-655)+(1.062)+(2.028), (I-655)+(1.062)+(2.029), (I-655)+(1.062)+(2.030), (I-655)+(1.062)+(2.031), (I-655)+(1.062)+(2.032), (I-655)+(1.062)+(2.033), (I-655)+(1.062)+(2.034), (I-655)+(1.062)+(2.035), (I-655)+(1.062)+(2.036), (I-655)+(1.062)+(2.037), (I-655)+(1.062)+(2.038), (I-655)+(1.062)+(2.039), (I-655)+(1.062)+(2.040), (I-655)+(1.062)+(2.041), (I-655)+(1.062)+(2.042), (I-655)+(1.062)+(2.043), (I-655)+(1.062)+(2.044), (I-655)+(1.062)+(2.045), (I-655)+(1.062)+(2.046), (I-655)+(1.062)+(2.047), (I-655)+(1.062)+(2.048), (I-655)+(1.062)+(2.049), (I-655)+(1.062)+(2.050), (I-655)+(1.062)+(2.051), (I-655)+(1.062)+(2.052), (I-655)+(1.062)+(2.053), (I-655)+(1.062)+(2.054), (I-655)+(1.062)+(2.055), (I-655)+(1.062)+(2.056), (I-655)+(1.062)+(2.057), (I-655)+(1.062)+(2.058), (I-655)+(1.062)+(2.059), (I-655)+(1.062)+(3.001), (I-655)+(1.062)+(3.002), (I-655)+(1.062)+(3.003), (I-655)+(1.062)+(3.004), (I-655)+(1.062)+(3.005), (I-655)+(1.062)+(3.006), (I-655)+(1.062)+(3.007), (I-655)+(1.062)+(3.008), (I-655)+(1.062)+(3.009), (I-655)+(1.062)+(3.010), (I-655)+(1.062)+(3.011), (I-655)+(1.062)+(3.012), (I-655)+(1.062)+(3.013), (I-655)+(1.062)+(3.014), (I-655)+(1.062)+(3.015), (I-655)+(1.062)+(3.016), (I-655)+(1.062)+(3.017), (I-655)+(1.062)+(3.018), (I-655)+(1.062)+(3.019), (I-655)+(1.062)+(3.020), (I-655)+(1.062)+(3.021), (I-655)+(1.062)+(3.022), (I-655)+(1.062)+(3.023), (I-655)+(1.062)+(3.024), (I-655)+(1.062)+(3.025), (I-655)+(1.062)+(3.026), (I-655)+(1.062)+(3.027), (I-655)+(1.062)+(3.028), (I-655)+(1.062)+(3.029), (I-655)+(1.062)+(3.030), (I-655)+(1.062)+(3.031), (I-655)+(1.062)+(5.001), (I-655)+(1.062)+(5.002), (I-655)+(1.062)+(5.003), (I-655)+(1.062)+(5.004), (I-655)+(1.062)+(5.005), (I-655)+(1.062)+(5.006), (I-655)+(1.062)+(5.007), (I-655)+(1.062)+(5.008), (I-655)+(1.062)+(5.009), (I-655)+(1.062)+(5.010), (I-655)+(1.062)+(5.011), (I-655)+(1.062)+(5.012), (I-655)+(1.062)+(5.013), (I-655)+(1.062)+(5.014), (I-655)+(1.062)+(5.015), (I-655)+(1.062)+(5.016), (I-655)+(1.062)+(5.017), (I-655)+(1.062)+(5.018), (I-655)+(1.062)+(5.019), (I-655)+(1.062)+(5.020), (I-655)+(1.062)+(5.021), (I-655)+(1.062)+(5.022), (I-655)+(1.062)+(5.023), (I-655)+(1.062)+(6.001), (I-655)+(1.062)+(6.002), (I-655)+(1.062)+(6.003), (I-655)+(1.062)+(6.004), (I-655)+(1.062)+(7.001), (I-655)+(1.062)+(7.002), (I-655)+(1.062)+(7.003), (I-655)+(1.062)+(7.004), (I-655)+(1.062)+(7.005), (I-655)+(1.062)+(7.006), (I-655)+(1.062)+(9.001), (I-655)+(1.062)+(9.002), (I-655)+(1.062)+(9.003), (I-655)+(1.062)+(9.004), (I-655)+(1.062)+(9.005), (I-655)+(1.062)+(9.006), (I-655)+(1.062)+(9.007), (I-655)+(1.062)+(9.008), (I-655)+(1.062)+(9.009), (I-655)+(1.062)+(14.001), (I-655)+(1.062)+(14.002), (I-655)+(1.062)+(15.008), (I-655)+(1.062)+(15.011), (I-655)+(1.062)+(15.012), (I-655)+(1.062)+(15.016), (I-655)+(1.062)+(15.025), (I-655)+(1.062)+(15.027), (I-655)+(1.062)+(15.047), (I-655)+(1.062)+(15.063), (I-655)+(1.062)+(15.064), (I-655)+(1.062)+(16.001), (I-655)+(1.062)+(16.002), (I-655)+(1.062)+(16.003), (I-655)+(1.062)+(16.004), (I-655)+(1.062)+(16.005), (I-655)+(1.062)+(16.006), (I-655)+(1.062)+(16.007), (I-655)+(1.062)+(16.008), (I-655)+(1.062)+(17.001), (I-655)+(1.062)+(17.002), (I-655)+(1.062)+(17.003), (I-655)+(1.062)+(17.004), (I-655)+(1.062)+(17.005), (I-655)+(1.062)+(17.006), (I-655)+(1.062)+(17.007), (I-655)+(1.062)+(17.008), (I-655)+(1.062)+(17.009), (I-655)+(1.062)+(17.010), (I-655)+(1.062)+(17.011), (I-655)+(1.062)+(17.012), (I-655)+(1.062)+(18.001),

(I-655)+(1.063)+(1.064), (I-655)+(1.063)+(1.065), (I-655)+(1.063)+(1.066), (I-655)+(1.063)+(1.067), (I-655)+(1.063)+(1.068), (I-655)+(1.063)+(1.069), (I-655)+(1.063)+(1.070), (I-655)+(1.063)+(1.071), (I-655)+(1.063)+(1.072), (I-655)+(1.063)+(1.073), (I-655)+(1.063)+(1.074), (I-655)+(1.063)+(1.075), (I-655)+(1.063)+(1.076), (I-655)+(1.063)+(1.077), (I-655)+(1.063)+(1.078), (I-655)+(1.063)+(1.079), (I-655)+(1.063)+(1.080), (I-655)+(1.063)+(1.081), (I-655)+(1.063)+(1.082), (I-655)+(1.063)+(1.083), (I-655)+(1.063)+(1.084), (I-655)+(1.063)+(1.085), (I-655)+(1.063)+(1.086), (I-655)+(1.063)+(1.087), (I-655)+(1.063)+(1.088), (I-655)+(1.063)+(1.089), (I-655)+(1.063)+(1.090), (I-655)+(1.063)+(1.091), (I-655)+(1.063)+(1.092), (I-655)+(1.063)+(2.001), (I-655)+(1.063)+(2.002), (I-655)+(1.063)+(2.003), (I-655)+(1.063)+(2.004), (I-655)+(1.063)+(2.005), (I-655)+(1.063)+(2.006), (I-655)+(1.063)+(2.007), (I-655)+(1.063)+(2.008), (I-655)+(1.063)+(2.009), (I-655)+(1.063)+(2.010), (I-655)+(1.063)+(2.011), (I-655)+(1.063)+(2.012), (I-655)+(1.063)+(2.013), (I-655)+(1.063)+(2.014), (I-655)+(1.063)+(2.015), (I-655)+(1.063)+(2.016), (I-655)+(1.063)+(2.017), (I-655)+(1.063)+(2.018), (I-655)+(1.063)+(2.019), (I-655)+(1.063)+(2.020), (I-655)+(1.063)+(2.021), (I-655)+(1.063)+(2.022), (I-655)+(1.063)+(2.023), (I-655)+(1.063)+(2.024), (I-655)+(1.063)+(2.025), (I-655)+(1.063)+(2.026), (I-655)+(1.063)+(2.027), (I-655)+(1.063)+(2.028), (I-655)+(1.063)+(2.029), (I-655)+(1.063)+(2.030), (I-655)+(1.063)+(2.031), (I-655)+(1.063)+(2.032), (I-655)+(1.063)+(2.033), (I-655)+(1.063)+(2.034), (I-655)+(1.063)+(2.035), (I-655)+(1.063)+(2.036), (I-655)+(1.063)+(2.037), (I-655)+(1.063)+(2.038), (I-655)+(1.063)+(2.039), (I-655)+(1.063)+(2.040), (I-655)+(1.063)+(2.041), (I-655)+(1.063)+(2.042), (I-655)+(1.063)+(2.043), (I-655)+(1.063)+(2.044), (I-655)+(1.063)+(2.045), (I-655)+(1.063)+(2.046), (I-655)+(1.063)+(2.047), (I-655)+(1.063)+(2.048), (I-655)+(1.063)+(2.049), (I-655)+(1.063)+(2.050), (I-655)+(1.063)+(2.051), (I-655)+(1.063)+(2.052), (I-655)+(1.063)+(2.053), (I-655)+(1.063)+(2.054), (I-655)+(1.063)+(2.055), (I-655)+(1.063)+(2.056), (I-655)+(1.063)+(2.057), (I-655)+(1.063)+(2.058), (I-655)+(1.063)+(2.059), (I-655)+(1.063)+(3.001), (I-655)+(1.063)+(3.002), (I-655)+(1.063)+(3.003), (I-655)+(1.063)+(3.004), (I-655)+(1.063)+(3.005), (I-655)+(1.063)+(3.006), (I-655)+(1.063)+(3.007), (I-655)+(1.063)+(3.008), (I-655)+(1.063)+(3.009), (I-655)+(1.063)+(3.010), (I-655)+(1.063)+(3.011), (I-655)+(1.063)+(3.012), (I-655)+(1.063)+(3.013), (I-655)+(1.063)+(3.014), (I-655)+(1.063)+(3.015), (I-655)+(1.063)+(3.016), (I-655)+(1.063)+(3.017), (I-655)+(1.063)+(3.018), (I-655)+(1.063)+(3.019), (I-655)+(1.063)+(3.020), (I-655)+(1.063)+(3.021), (I-655)+(1.063)+(3.022), (I-655)+(1.063)+(3.023), (I-655)+(1.063)+(3.024), (I-655)+(1.063)+(3.025), (I-655)+(1.063)+(3.026), (I-655)+(1.063)+(3.027), (I-655)+(1.063)+(3.028), (I-655)+(1.063)+(3.029), (I-655)+(1.063)+(3.030), (I-655)+(1.063)+(3.031), (I-655)+(1.063)+(5.001), (I-655)+(1.063)+(5.002), (I-655)+(1.063)+(5.003), (I-655)+(1.063)+(5.004), (I-655)+(1.063)+(5.005), (I-655)+(1.063)+(5.006), (I-655)+(1.063)+(5.007), (I-655)+(1.063)+(5.008), (I-655)+(1.063)+(5.009), (I-655)+(1.063)+(5.010), (I-655)+(1.063)+(5.011), (I-655)+(1.063)+(5.012), (I-655)+(1.063)+(5.013), (I-655)+(1.063)+(5.014), (I-655)+(1.063)+(5.015), (I-655)+(1.063)+(5.016), (I-655)+(1.063)+(5.017), (I-655)+(1.063)+(5.018), (I-655)+(1.063)+(5.019), (I-655)+(1.063)+(5.020), (I-655)+(1.063)+(5.021), (I-655)+(1.063)+(5.022), (I-655)+(1.063)+(5.023), (I-655)+(1.063)+(6.001), (I-655)+(1.063)+(6.002), (I-655)+(1.063)+(6.003), (I-655)+(1.063)+(6.004), (I-655)+(1.063)+(7.001), (I-655)+(1.063)+(7.002), (I-655)+(1.063)+(7.003), (I-655)+(1.063)+(7.004), (I-655)+(1.063)+(7.005), (I-655)+(1.063)+(7.006), (I-655)+(1.063)+(9.001), (I-655)+(1.063)+(9.002), (I-655)+(1.063)+(9.003), (I-655)+(1.063)+(9.004), (I-655)+(1.063)+(9.005), (I-655)+(1.063)+(9.006), (I-655)+(1.063)+(9.007), (I-655)+(1.063)+(9.008), (I-655)+(1.063)+(9.009), (I-655)+(1.063)+(14.001), (I-655)+(1.063)+(14.002), (I-655)+(1.063)+(15.008), (I-655)+(1.063)+(15.011), (I-655)+(1.063)+(15.012), (I-655)+(1.063)+(15.016), (I-655)+(1.063)+(15.025), (I-655)+(1.063)+(15.027), (I-655)+(1.063)+(15.047), (I-655)+(1.063)+(15.063), (I-655)+(1.063)+(15.064), (I-655)+(1.063)+(16.001), (I-655)+(1.063)+(16.002), (I-655)+(1.063)+(16.003), (I-655)+(1.063)+(16.004), (I-655)+(1.063)+(16.005), (I-655)+(1.063)+(16.006), (I-655)+(1.063)+(16.007), (I-655)+(1.063)+(16.008), (I-655)+(1.063)+(17.001), (I-655)+(1.063)+(17.002), (I-655)+(1.063)+(17.003), (I-655)+(1.063)+(17.004), (I-655)+(1.063)+(17.005), (I-655)+(1.063)+(17.006), (I-655)+(1.063)+(17.007), (I-655)+(1.063)+(17.008), (I-655)+(1.063)+(17.009), (I-655)+(1.063)+(17.010), (I-655)+(1.063)+(17.011), (I-655)+(1.063)+(17.012), (I-655)+(1.063)+(18.001),

(I-655)+(1.064)+(1.065), (I-655)+(1.064)+(1.066), (I-655)+(1.064)+(1.067), (I-655)+(1.064)+(1.068), (I-655)+(1.064)+(1.069), (I-655)+(1.064)+(1.070), (I-655)+(1.064)+(1.071), (I-655)+(1.064)+(1.072), (I-655)+(1.064)+(1.073), (I-655)+(1.064)+(1.074), (I-655)+(1.064)+(1.075), (I-655)+(1.064)+(1.076), (I-655)+(1.064)+(1.077), (I-655)+(1.064)+(1.078), (I-655)+(1.064)+(1.079), (I-655)+(1.064)+(1.080), (I-655)+(1.064)+(1.081), (I-655)+(1.064)+(1.082), (I-655)+(1.064)+(1.083), (I-655)+(1.064)+(1.084), (I-655)+(1.064)+(1.085), (I-655)+(1.064)+(1.086), (I-655)+(1.064)+(1.087), (I-655)+(1.064)+(1.088), (I-655)+(1.064)+(1.089), (I-655)+(1.064)+(1.090), (I-655)+(1.064)+(1.091), (I-655)+(1.064)+(1.092), (I-655)+(1.064)+(2.001), (I-655)+(1.064)+(2.002), (I-655)+(1.064)+(2.003), (I-655)+(1.064)+(2.004), (I-655)+(1.064)+(2.005), (I-655)+(1.064)+(2.006), (I-655)+(1.064)+(2.007), (I-655)+(1.064)+(2.008), (I-655)+(1.064)+(2.009), (I-655)+(1.064)+(2.010), (I-655)+(1.064)+(2.011), (I-655)+(1.064)+(2.012), (I-655)+(1.064)+(2.013), (I-655)+(1.064)+(2.014), (I-655)+(1.064)+(2.015), (I-655)+(1.064)+(2.016), (I-655)+(1.064)+(2.017), (I-655)+(1.064)+(2.018), (I-655)+(1.064)+(2.019), (I-655)+(1.064)+(2.020), (I-655)+(1.064)+(2.021), (I-655)+(1.064)+(2.022), (I-655)+(1.064)+(2.023), (I-655)+(1.064)+(2.024), (I-655)+(1.064)+(2.025), (I-655)+(1.064)+(2.026), (I-655)+(1.064)+(2.027), (I-655)+(1.064)+(2.028), (I-655)+(1.064)+(2.029), (I-655)+(1.064)+(2.030), (I-655)+(1.064)+(2.031), (I-655)+(1.064)+(2.032), (I-655)+(1.064)+(2.033), (I-655)+(1.064)+(2.034), (I-655)+(1.064)+(2.035), (I-655)+(1.064)+(2.036), (I-655)+(1.064)+(2.037), (I-655)+(1.064)+(2.038), (I-655)+(1.064)+(2.039), (I-655)+(1.064)+(2.040), (I-655)+(1.064)+(2.041), (I-655)+(1.064)+(2.042), (I-655)+(1.064)+(2.043), (I-655)+(1.064)+(2.044), (I-655)+(1.064)+(2.045), (I-655)+(1.064)+(2.046), (I-655)+(1.064)+(2.047), (I-655)+(1.064)+(2.048), (I-655)+(1.064)+(2.049), (I-655)+(1.064)+(2.050), (I-655)+(1.064)+(2.051), (I-655)+(1.064)+(2.052), (I-655)+(1.064)+(2.053), (I-655)+(1.064)+(2.054), (I-655)+(1.064)+(2.055), (I-655)+(1.064)+(2.056), (I-655)+(1.064)+(2.057), (I-655)+(1.064)+(2.058), (I-655)+(1.064)+(2.059), (I-655)+(1.064)+(3.001), (I-655)+(1.064)+(3.002), (I-655)+(1.064)+(3.003), (I-655)+(1.064)+(3.004), (I-655)+(1.064)+(3.005), (I-655)+(1.064)+(3.006), (I-655)+(1.064)+(3.007), (I-655)+(1.064)+(3.008), (I-655)+(1.064)+(3.009), (I-655)+(1.064)+(3.010), (I-655)+(1.064)+(3.011), (I-655)+(1.064)+(3.012), (I-655)+(1.064)+(3.013), (I-655)+(1.064)+(3.014), (I-655)+(1.064)+(3.015), (I-655)+(1.064)+(3.016), (I-655)+(1.064)+(3.017), (I-655)+(1.064)+(3.018), (I-655)+(1.064)+(3.019), (I-655)+(1.064)+(3.020), (I-655)+(1.064)+(3.021), (I-655)+(1.064)+(3.022), (I-655)+(1.064)+(3.023), (I-655)+(1.064)+(3.024), (I-655)+(1.064)+(3.025), (I-655)+(1.064)+(3.026), (I-655)+(1.064)+(3.027), (I-655)+(1.064)+(3.028), (I-655)+(1.064)+(3.029), (I-655)+(1.064)+(3.030), (I-655)+(1.064)+(3.031), (I-655)+(1.064)+(5.001), (I-655)+(1.064)+(5.002), (I-655)+(1.064)+(5.003), (I-655)+(1.064)+(5.004), (I-655)+(1.064)+(5.005), (I-655)+(1.064)+(5.006), (I-655)+(1.064)+(5.007), (I-655)+(1.064)+(5.008), (I-655)+(1.064)+(5.009), (I-655)+(1.064)+(5.010), (I-655)+(1.064)+(5.011), (I-655)+(1.064)+(5.012), (I-655)+(1.064)+(5.013), (I-655)+(1.064)+(5.014), (I-655)+(1.064)+(5.015), (I-655)+(1.064)+(5.016), (I-655)+(1.064)+(5.017), (I-655)+(1.064)+(5.018), (I-655)+(1.064)+(5.019), (I-655)+(1.064)+(5.020), (I-655)+(1.064)+(5.021), (I-655)+(1.064)+(5.022), (I-655)+(1.064)+(5.023), (I-655)+(1.064)+(6.001), (I-655)+(1.064)+(6.002), (I-655)+(1.064)+(6.003), (I-655)+(1.064)+(6.004), (I-655)+(1.064)+(7.001), (I-655)+(1.064)+(7.002), (I-655)+(1.064)+(7.003), (I-655)+(1.064)+(7.004), (I-655)+(1.064)+(7.005), (I-655)+(1.064)+(7.006), (I-655)+(1.064)+(9.001), (I-655)+(1.064)+(9.002), (I-655)+(1.064)+(9.003), (I-655)+(1.064)+(9.004), (I-655)+(1.064)+(9.005), (I-655)+(1.064)+(9.006), (I-655)+(1.064)+(9.007), (I-655)+(1.064)+(9.008), (I-655)+(1.064)+(9.009), (I-655)+(1.064)+(14.001), (I-655)+(1.064)+(14.002), (I-655)+(1.064)+(15.008), (I-655)+(1.064)+(15.011), (I-655)+(1.064)+(15.012), (I-655)+(1.064)+(15.016), (I-655)+(1.064)+(15.025), (I-655)+(1.064)+(15.027), (I-655)+(1.064)+(15.047), (I-655)+(1.064)+(15.063), (I-655)+(1.064)+(15.064), (I-655)+(1.064)+(16.001), (I-655)+(1.064)+(16.002), (I-655)+(1.064)+(16.003), (I-655)+(1.064)+(16.004), (I-655)+(1.064)+(16.005), (I-655)+(1.064)+(16.006), (I-655)+(1.064)+(16.007), (I-655)+(1.064)+(16.008), (I-655)+(1.064)+(17.001), (I-655)+(1.064)+(17.002), (I-655)+(1.064)+(17.003), (I-655)+(1.064)+(17.004), (I-655)+(1.064)+(17.005), (I-655)+(1.064)+(17.006), (I-655)+(1.064)+(17.007), (I-655)+(1.064)+(17.008), (I-655)+(1.064)+(17.009), (I-655)+(1.064)+(17.010), (I-655)+(1.064)+(17.011), (I-655)+(1.064)+(17.012), (I-655)+(1.064)+(18.001),

(I-655)+(1.065)+(1.066), (I-655)+(1.065)+(1.067), (I-655)+(1.065)+(1.068), (I-655)+(1.065)+(1.069), (I-655)+(1.065)+(1.070), (I-655)+(1.065)+(1.071), (I-655)+(1.065)+(1.072), (I-655)+(1.065)+(1.073), (I-655)+(1.065)+(1.074), (I-655)+(1.065)+(1.075), (I-655)+(1.065)+(1.076), (I-655)+(1.065)+(1.077), (I-655)+(1.065)+(1.078), (I-655)+(1.065)+(1.079), (I-655)+(1.065)+(1.080), (I-655)+(1.065)+(1.081), (I-655)+(1.065)+(1.082), (I-655)+(1.065)+(1.083), (I-655)+(1.065)+(1.084), (I-655)+(1.065)+(1.085), (I-655)+(1.065)+(1.086), (I-655)+(1.065)+(1.087), (I-655)+(1.065)+(1.088), (I-655)+(1.065)+(1.089), (I-655)+(1.065)+(1.090), (I-655)+(1.065)+(1.091), (I-655)+(1.065)+(1.092), (I-655)+(1.065)+(2.001), (I-655)+(1.065)+(2.002), (I-655)+(1.065)+(2.003), (I-655)+(1.065)+(2.004), (I-655)+(1.065)+(2.005), (I-655)+(1.065)+(2.006), (I-655)+(1.065)+(2.007), (I-655)+(1.065)+(2.008), (I-655)+(1.065)+(2.009), (I-655)+(1.065)+(2.010), (I-655)+(1.065)+(2.011), (I-655)+(1.065)+(2.012), (I-655)+(1.065)+(2.013), (I-655)+(1.065)+(2.014), (I-655)+(1.065)+(2.015), (I-655)+(1.065)+(2.016), (I-655)+(1.065)+(2.017), (I-655)+(1.065)+(2.018), (I-655)+(1.065)+(2.019), (I-655)+(1.065)+(2.020), (I-655)+(1.065)+(2.021), (I-655)+(1.065)+(2.022), (I-655)+(1.065)+(2.023), (I-655)+(1.065)+(2.024), (I-655)+(1.065)+(2.025), (I-655)+(1.065)+(2.026), (I-655)+(1.065)+(2.027), (I-655)+(1.065)+(2.028), (I-655)+(1.065)+(2.029), (I-655)+(1.065)+(2.030), (I-655)+(1.065)+(2.031), (I-655)+(1.065)+(2.032), (I-655)+(1.065)+(2.033), (I-655)+(1.065)+(2.034), (I-655)+(1.065)+(2.035), (I-655)+(1.065)+(2.036), (I-655)+(1.065)+(2.037), (I-655)+(1.065)+(2.038), (I-655)+(1.065)+(2.039), (I-655)+(1.065)+(2.040), (I-655)+(1.065)+(2.041), (I-655)+(1.065)+(2.042), (I-655)+(1.065)+(2.043), (I-655)+(1.065)+(2.044), (I-655)+(1.065)+(2.045), (I-655)+(1.065)+(2.046), (I-655)+(1.065)+(2.047), (I-655)+(1.065)+(2.048), (I-655)+(1.065)+(2.049), (I-655)+(1.065)+(2.050), (I-655)+(1.065)+(2.051), (I-655)+(1.065)+(2.052), (I-655)+(1.065)+(2.053), (I-655)+(1.065)+(2.054), (I-655)+(1.065)+(2.055), (I-655)+(1.065)+(2.056), (I-655)+(1.065)+(2.057), (I-655)+(1.065)+(2.058), (I-655)+(1.065)+(2.059), (I-655)+(1.065)+(3.001), (I-655)+(1.065)+(3.002), (I-655)+(1.065)+(3.003), (I-655)+(1.065)+(3.004), (I-655)+(1.065)+(3.005), (I-655)+(1.065)+(3.006), (I-655)+(1.065)+(3.007), (I-655)+(1.065)+(3.008), (I-655)+(1.065)+(3.009), (I-655)+(1.065)+(3.010), (I-655)+(1.065)+(3.011), (I-655)+(1.065)+(3.012), (I-655)+(1.065)+(3.013), (I-655)+(1.065)+(3.014), (I-655)+(1.065)+(3.015), (I-655)+(1.065)+(3.016), (I-655)+(1.065)+(3.017), (I-655)+(1.065)+(3.018), (I-655)+(1.065)+(3.019), (I-655)+(1.065)+(3.020), (I-655)+(1.065)+(3.021), (I-655)+(1.065)+(3.022), (I-655)+(1.065)+(3.023), (I-655)+(1.065)+(3.024), (I-655)+(1.065)+(3.025), (I-655)+(1.065)+(3.026), (I-655)+(1.065)+(3.027), (I-655)+(1.065)+(3.028), (I-655)+(1.065)+(3.029), (I-655)+(1.065)+(3.030), (I-655)+(1.065)+(3.031), (I-655)+(1.065)+(5.001), (I-655)+(1.065)+(5.002), (I-655)+(1.065)+(5.003), (I-655)+(1.065)+(5.004), (I-655)+(1.065)+(5.005), (I-655)+(1.065)+(5.006), (I-655)+(1.065)+(5.007), (I-655)+(1.065)+(5.008), (I-655)+(1.065)+(5.009), (I-655)+(1.065)+(5.010), (I-655)+(1.065)+(5.011), (I-655)+(1.065)+(5.012), (I-655)+(1.065)+(5.013), (I-655)+(1.065)+(5.014), (I-655)+(1.065)+(5.015), (I-655)+(1.065)+(5.016), (I-655)+(1.065)+(5.017), (I-655)+(1.065)+(5.018), (I-655)+(1.065)+(5.019), (I-655)+(1.065)+(5.020), (I-655)+(1.065)+(5.021), (I-655)+(1.065)+(5.022), (I-655)+(1.065)+(5.023), (I-655)+(1.065)+(6.001), (I-655)+(1.065)+(6.002), (I-655)+(1.065)+(6.003), (I-655)+(1.065)+(6.004), (I-655)+(1.065)+(7.001), (I-655)+(1.065)+(7.002), (I-655)+(1.065)+(7.003), (I-655)+(1.065)+(7.004), (I-655)+(1.065)+(7.005), (I-655)+(1.065)+(7.006), (I-655)+(1.065)+(9.001), (I-655)+(1.065)+(9.002), (I-655)+(1.065)+(9.003), (I-655)+(1.065)+(9.004), (I-655)+(1.065)+(9.005), (I-655)+(1.065)+(9.006), (I-655)+(1.065)+(9.007), (I-655)+(1.065)+(9.008), (I-655)+(1.065)+(9.009), (I-655)+(1.065)+(14.001), (I-655)+(1.065)+(14.002), (I-655)+(1.065)+(15.008), (I-655)+(1.065)+(15.011), (I-655)+(1.065)+(15.012), (I-655)+(1.065)+(15.016), (I-655)+(1.065)+(15.025), (I-655)+(1.065)+(15.027), (I-655)+(1.065)+(15.047), (I-655)+(1.065)+(15.063), (I-655)+(1.065)+(15.064), (I-655)+(1.065)+(16.001), (I-655)+(1.065)+(16.002), (I-655)+(1.065)+(16.003), (I-655)+(1.065)+(16.004), (I-655)+(1.065)+(16.005), (I-655)+(1.065)+(16.006), (I-655)+(1.065)+(16.007), (I-655)+(1.065)+(16.008), (I-655)+(1.065)+(17.001), (I-655)+(1.065)+(17.002), (I-655)+(1.065)+(17.003), (I-655)+(1.065)+(17.004), (I-655)+(1.065)+(17.005), (I-655)+(1.065)+(17.006), (I-655)+(1.065)+(17.007), (I-655)+(1.065)+(17.008), (I-655)+(1.065)+(17.009), (I-655)+(1.065)+(17.010), (I-655)+(1.065)+(17.011), (I-655)+(1.065)+(17.012), (I-655)+(1.065)+(18.001),

(I-655)+(1.066)+(1.067), (I-655)+(1.066)+(1.068), (I-655)+(1.066)+(1.069), (I-655)+(1.066)+(1.070), (I-655)+(1.066)+(1.071), (I-655)+(1.066)+(1.072), (I-655)+(1.066)+(1.073), (I-655)+(1.066)+(1.074), (I-655)+(1.066)+(1.075), (I-655)+(1.066)+(1.076), (I-655)+(1.066)+(1.077), (I-655)+(1.066)+(1.078), (I-655)+(1.066)+(1.079), (I-655)+(1.066)+(1.080), (I-655)+(1.066)+(1.081), (I-655)+(1.066)+(1.082), (I-655)+(1.066)+(1.083), (I-655)+(1.066)+(1.084), (I-655)+(1.066)+(1.085), (I-655)+(1.066)+(1.086), (I-655)+(1.066)+(1.087), (I-655)+(1.066)+(1.088), (I-655)+(1.066)+(1.089), (I-655)+(1.066)+(1.090), (I-655)+(1.066)+(1.091), (I-655)+(1.066)+(1.092), (I-655)+(1.066)+(2.001), (I-655)+(1.066)+(2.002), (I-655)+(1.066)+(2.003), (I-655)+(1.066)+(2.004), (I-655)+(1.066)+(2.005), (I-655)+(1.066)+(2.006), (I-655)+(1.066)+(2.007), (I-655)+(1.066)+(2.008), (I-655)+(1.066)+(2.009), (I-655)+(1.066)+(2.010), (I-655)+(1.066)+(2.011), (I-655)+(1.066)+(2.012), (I-655)+(1.066)+(2.013), (I-655)+(1.066)+(2.014), (I-655)+(1.066)+(2.015), (I-655)+(1.066)+(2.016), (I-655)+(1.066)+(2.017), (I-655)+(1.066)+(2.018), (I-655)+(1.066)+(2.019), (I-655)+(1.066)+(2.020), (I-655)+(1.066)+(2.021), (I-655)+(1.066)+(2.022), (I-655)+(1.066)+(2.023), (I-655)+(1.066)+(2.024), (I-655)+(1.066)+(2.025), (I-655)+(1.066)+(2.026), (I-655)+(1.066)+(2.027), (I-655)+(1.066)+(2.028), (I-655)+(1.066)+(2.029), (I-655)+(1.066)+(2.030), (I-655)+(1.066)+(2.031), (I-655)+(1.066)+(2.032), (I-655)+(1.066)+(2.033), (I-655)+(1.066)+(2.034), (I-655)+(1.066)+(2.035), (I-655)+(1.066)+(2.036), (I-655)+(1.066)+(2.037), (I-655)+(1.066)+(2.038), (I-655)+(1.066)+(2.039), (I-655)+(1.066)+(2.040), (I-655)+(1.066)+(2.041), (I-655)+(1.066)+(2.042), (I-655)+(1.066)+(2.043), (I-655)+(1.066)+(2.044), (I-655)+(1.066)+(2.045), (I-655)+(1.066)+(2.046), (I-655)+(1.066)+(2.047), (I-655)+(1.066)+(2.048), (I-655)+(1.066)+(2.049), (I-655)+(1.066)+(2.050), (I-655)+(1.066)+(2.051), (I-655)+(1.066)+(2.052), (I-655)+(1.066)+(2.053), (I-655)+(1.066)+(2.054), (I-655)+(1.066)+(2.055), (I-655)+(1.066)+(2.056), (I-655)+(1.066)+(2.057), (I-655)+(1.066)+(2.058), (I-655)+(1.066)+(2.059), (I-655)+(1.066)+(3.001), (I-655)+(1.066)+(3.002), (I-655)+(1.066)+(3.003), (I-655)+(1.066)+(3.004), (I-655)+(1.066)+(3.005), (I-655)+(1.066)+(3.006), (I-655)+(1.066)+(3.007), (I-655)+(1.066)+(3.008), (I-655)+(1.066)+(3.009), (I-655)+(1.066)+(3.010), (I-655)+(1.066)+(3.011), (I-655)+(1.066)+(3.012), (I-655)+(1.066)+(3.013), (I-655)+(1.066)+(3.014), (I-655)+(1.066)+(3.015), (I-655)+(1.066)+(3.016), (I-655)+(1.066)+(3.017), (I-655)+(1.066)+(3.018), (I-655)+(1.066)+(3.019), (I-655)+(1.066)+(3.020), (I-655)+(1.066)+(3.021), (I-655)+(1.066)+(3.022), (I-655)+(1.066)+(3.023), (I-655)+(1.066)+(3.024), (I-655)+(1.066)+(3.025), (I-655)+(1.066)+(3.026), (I-655)+(1.066)+(3.027), (I-655)+(1.066)+(3.028), (I-655)+(1.066)+(3.029), (I-655)+(1.066)+(3.030), (I-655)+(1.066)+(3.031), (I-655)+(1.066)+(5.001), (I-655)+(1.066)+(5.002), (I-655)+(1.066)+(5.003), (I-655)+(1.066)+(5.004), (I-655)+(1.066)+(5.005), (I-655)+(1.066)+(5.006), (I-655)+(1.066)+(5.007), (I-655)+(1.066)+(5.008), (I-655)+(1.066)+(5.009), (I-655)+(1.066)+(5.010), (I-655)+(1.066)+(5.011), (I-655)+(1.066)+(5.012), (I-655)+(1.066)+(5.013), (I-655)+(1.066)+(5.014), (I-655)+(1.066)+(5.015), (I-655)+(1.066)+(5.016), (I-655)+(1.066)+(5.017), (I-655)+(1.066)+(5.018), (I-655)+(1.066)+(5.019), (I-655)+(1.066)+(5.020), (I-655)+(1.066)+(5.021), (I-655)+(1.066)+(5.022), (I-655)+(1.066)+(5.023), (I-655)+(1.066)+(6.001), (I-655)+(1.066)+(6.002), (I-655)+(1.066)+(6.003), (I-655)+(1.066)+(6.004), (I-655)+(1.066)+(7.001), (I-655)+(1.066)+(7.002), (I-655)+(1.066)+(7.003), (I-655)+(1.066)+(7.004), (I-655)+(1.066)+(7.005), (I-655)+(1.066)+(7.006), (I-655)+(1.066)+(9.001), (I-655)+(1.066)+(9.002), (I-655)+(1.066)+(9.003), (I-655)+(1.066)+(9.004), (I-655)+(1.066)+(9.005), (I-655)+(1.066)+(9.006), (I-655)+(1.066)+(9.007), (I-655)+(1.066)+(9.008), (I-655)+(1.066)+(9.009), (I-655)+(1.066)+(14.001), (I-655)+(1.066)+(14.002), (I-655)+(1.066)+(15.008), (I-655)+(1.066)+(15.011), (I-655)+(1.066)+(15.012), (I-655)+(1.066)+(15.016), (I-655)+(1.066)+(15.025), (I-655)+(1.066)+(15.027), (I-655)+(1.066)+(15.047), (I-655)+(1.066)+(15.063), (I-655)+(1.066)+(15.064), (I-655)+(1.066)+(16.001), (I-655)+(1.066)+(16.002), (I-655)+(1.066)+(16.003), (I-655)+(1.066)+(16.004), (I-655)+(1.066)+(16.005), (I-655)+(1.066)+(16.006), (I-655)+(1.066)+(16.007), (I-655)+(1.066)+(16.008), (I-655)+(1.066)+(17.001), (I-655)+(1.066)+(17.002), (I-655)+(1.066)+(17.003), (I-655)+(1.066)+(17.004), (I-655)+(1.066)+(17.005), (I-655)+(1.066)+(17.006), (I-655)+(1.066)+(17.007), (I-655)+(1.066)+(17.008), (I-655)+(1.066)+(17.009), (I-655)+(1.066)+(17.010), (I-655)+(1.066)+(17.011), (I-655)+(1.066)+(17.012), (I-655)+(1.066)+(18.001),

(I-655)+(1.067)+(1.068), (I-655)+(1.067)+(1.069), (I-655)+(1.067)+(1.070), (I-655)+(1.067)+(1.071), (I-655)+(1.067)+(1.072), (I-655)+(1.067)+(1.073), (I-655)+(1.067)+(1.074), (I-655)+(1.067)+(1.075), (I-655)+(1.067)+(1.076), (I-655)+(1.067)+(1.077), (I-655)+(1.067)+(1.078), (I-655)+(1.067)+(1.079), (I-655)+(1.067)+(1.080), (I-655)+(1.067)+(1.081), (I-655)+(1.067)+(1.082), (I-655)+(1.067)+(1.083), (I-655)+(1.067)+(1.084), (I-655)+(1.067)+(1.085), (I-655)+(1.067)+(1.086), (I-655)+(1.067)+(1.087), (I-655)+(1.067)+(1.088), (I-655)+(1.067)+(1.089), (I-655)+(1.067)+(1.090), (I-655)+(1.067)+(1.091), (I-655)+(1.067)+(1.092), (I-655)+(1.067)+(2.001), (I-655)+(1.067)+(2.002), (I-655)+(1.067)+(2.003), (I-655)+(1.067)+(2.004), (I-655)+(1.067)+(2.005), (I-655)+(1.067)+(2.006), (I-655)+(1.067)+(2.007), (I-655)+(1.067)+(2.008), (I-655)+(1.067)+(2.009), (I-655)+(1.067)+(2.010), (I-655)+(1.067)+(2.011), (I-655)+(1.067)+(2.012), (I-655)+(1.067)+(2.013), (I-655)+(1.067)+(2.014), (I-655)+(1.067)+(2.015), (I-655)+(1.067)+(2.016), (I-655)+(1.067)+(2.017), (I-655)+(1.067)+(2.018), (I-655)+(1.067)+(2.019), (I-655)+(1.067)+(2.020), (I-655)+(1.067)+(2.021), (I-655)+(1.067)+(2.022), (I-655)+(1.067)+(2.023), (I-655)+(1.067)+(2.024), (I-655)+(1.067)+(2.025), (I-655)+(1.067)+(2.026), (I-655)+(1.067)+(2.027), (I-655)+(1.067)+(2.028), (I-655)+(1.067)+(2.029), (I-655)+(1.067)+(2.030), (I-655)+(1.067)+(2.031), (I-655)+(1.067)+(2.032), (I-655)+(1.067)+(2.033), (I-655)+(1.067)+(2.034), (I-655)+(1.067)+(2.035), (I-655)+(1.067)+(2.036), (I-655)+(1.067)+(2.037), (I-655)+(1.067)+(2.038), (I-655)+(1.067)+(2.039), (I-655)+(1.067)+(2.040), (I-655)+(1.067)+(2.041), (I-655)+(1.067)+(2.042), (I-655)+(1.067)+(2.043), (I-655)+(1.067)+(2.044), (I-655)+(1.067)+(2.045), (I-655)+(1.067)+(2.046), (I-655)+(1.067)+(2.047), (I-655)+(1.067)+(2.048), (I-655)+(1.067)+(2.049), (I-655)+(1.067)+(2.050), (I-655)+(1.067)+(2.051), (I-655)+(1.067)+(2.052), (I-655)+(1.067)+(2.053), (I-655)+(1.067)+(2.054), (I-655)+(1.067)+(2.055), (I-655)+(1.067)+(2.056), (I-655)+(1.067)+(2.057), (I-655)+(1.067)+(2.058), (I-655)+(1.067)+(2.059), (I-655)+(1.067)+(3.001), (I-655)+(1.067)+(3.002), (I-655)+(1.067)+(3.003), (I-655)+(1.067)+(3.004), (I-655)+(1.067)+(3.005), (I-655)+(1.067)+(3.006), (I-655)+(1.067)+(3.007), (I-655)+(1.067)+(3.008), (I-655)+(1.067)+(3.009), (I-655)+(1.067)+(3.010), (I-655)+(1.067)+(3.011), (I-655)+(1.067)+(3.012), (I-655)+(1.067)+(3.013), (I-655)+(1.067)+(3.014), (I-655)+(1.067)+(3.015), (I-655)+(1.067)+(3.016), (I-655)+(1.067)+(3.017), (I-655)+(1.067)+(3.018), (I-655)+(1.067)+(3.019), (I-655)+(1.067)+(3.020), (I-655)+(1.067)+(3.021), (I-655)+(1.067)+(3.022), (I-655)+(1.067)+(3.023), (I-655)+(1.067)+(3.024), (I-655)+(1.067)+(3.025), (I-655)+(1.067)+(3.026), (I-655)+(1.067)+(3.027), (I-655)+(1.067)+(3.028), (I-655)+(1.067)+(3.029), (I-655)+(1.067)+(3.030), (I-655)+(1.067)+(3.031), (I-655)+(1.067)+(5.001), (I-655)+(1.067)+(5.002), (I-655)+(1.067)+(5.003), (I-655)+(1.067)+(5.004), (I-655)+(1.067)+(5.005), (I-655)+(1.067)+(5.006), (I-655)+(1.067)+(5.007), (I-655)+(1.067)+(5.008), (I-655)+(1.067)+(5.009), (I-655)+(1.067)+(5.010), (I-655)+(1.067)+(5.011), (I-655)+(1.067)+(5.012), (I-655)+(1.067)+(5.013), (I-655)+(1.067)+(5.014), (I-655)+(1.067)+(5.015), (I-655)+(1.067)+(5.016), (I-655)+(1.067)+(5.017), (I-655)+(1.067)+(5.018), (I-655)+(1.067)+(5.019), (I-655)+(1.067)+(5.020), (I-655)+(1.067)+(5.021), (I-655)+(1.067)+(5.022), (I-655)+(1.067)+(5.023), (I-655)+(1.067)+(6.001), (I-655)+(1.067)+(6.002), (I-655)+(1.067)+(6.003), (I-655)+(1.067)+(6.004), (I-655)+(1.067)+(7.001), (I-655)+(1.067)+(7.002), (I-655)+(1.067)+(7.003), (I-655)+(1.067)+(7.004), (I-655)+(1.067)+(7.005), (I-655)+(1.067)+(7.006), (I-655)+(1.067)+(9.001), (I-655)+(1.067)+(9.002), (I-655)+(1.067)+(9.003), (I-655)+(1.067)+(9.004), (I-655)+(1.067)+(9.005), (I-655)+(1.067)+(9.006), (I-655)+(1.067)+(9.007), (I-655)+(1.067)+(9.008), (I-655)+(1.067)+(9.009), (I-655)+(1.067)+(14.001), (I-655)+(1.067)+(14.002), (I-655)+(1.067)+(15.008), (I-655)+(1.067)+(15.011), (I-655)+(1.067)+(15.012), (I-655)+(1.067)+(15.016), (I-655)+(1.067)+(15.025), (I-655)+(1.067)+(15.027), (I-655)+(1.067)+(15.047), (I-655)+(1.067)+(15.063), (I-655)+(1.067)+(15.064), (I-655)+(1.067)+(16.001), (I-655)+(1.067)+(16.002), (I-655)+(1.067)+(16.003), (I-655)+(1.067)+(16.004), (I-655)+(1.067)+(16.005), (I-655)+(1.067)+(16.006), (I-655)+(1.067)+(16.007), (I-655)+(1.067)+(16.008), (I-655)+(1.067)+(17.001), (I-655)+(1.067)+(17.002), (I-655)+(1.067)+(17.003), (I-655)+(1.067)+(17.004), (I-655)+(1.067)+(17.005), (I-655)+(1.067)+(17.006), (I-655)+(1.067)+(17.007), (I-655)+(1.067)+(17.008), (I-655)+(1.067)+(17.009), (I-655)+(1.067)+(17.010), (I-655)+(1.067)+(17.011), (I-655)+(1.067)+(17.012), (I-655)+(1.067)+(18.001),

(I-655)+(1.068)+(1.069), (I-655)+(1.068)+(1.070), (I-655)+(1.068)+(1.071), (I-655)+(1.068)+(1.072), (I-655)+(1.068)+(1.073), (I-655)+(1.068)+(1.074), (I-655)+(1.068)+(1.075), (I-655)+(1.068)+(1.076), (I-655)+(1.068)+(1.077), (I-655)+(1.068)+(1.078), (I-655)+(1.068)+(1.079), (I-655)+(1.068)+(1.080), (I-655)+(1.068)+(1.081), (I-655)+(1.068)+(1.082), (I-655)+(1.068)+(1.083), (I-655)+(1.068)+(1.084), (I-655)+(1.068)+(1.085), (I-655)+(1.068)+(1.086), (I-655)+(1.068)+(1.087), (I-655)+(1.068)+(1.088), (I-655)+(1.068)+(1.089), (I-655)+(1.068)+(1.090), (I-655)+(1.068)+(1.091), (I-655)+(1.068)+(1.092), (I-655)+(1.068)+(2.001), (I-655)+(1.068)+(2.002), (I-655)+(1.068)+(2.003), (I-655)+(1.068)+(2.004), (I-655)+(1.068)+(2.005), (I-655)+(1.068)+(2.006), (I-655)+(1.068)+(2.007), (I-655)+(1.068)+(2.008), (I-655)+(1.068)+(2.009), (I-655)+(1.068)+(2.010), (I-655)+(1.068)+(2.011), (I-655)+(1.068)+(2.012), (I-655)+(1.068)+(2.013), (I-655)+(1.068)+(2.014), (I-655)+(1.068)+(2.015), (I-655)+(1.068)+(2.016), (I-655)+(1.068)+(2.017), (I-655)+(1.068)+(2.018), (I-655)+(1.068)+(2.019), (I-655)+(1.068)+(2.020), (I-655)+(1.068)+(2.021), (I-655)+(1.068)+(2.022), (I-655)+(1.068)+(2.023), (I-655)+(1.068)+(2.024), (I-655)+(1.068)+(2.025), (I-655)+(1.068)+(2.026), (I-655)+(1.068)+(2.027), (I-655)+(1.068)+(2.028), (I-655)+(1.068)+(2.029), (I-655)+(1.068)+(2.030), (I-655)+(1.068)+(2.031), (I-655)+(1.068)+(2.032), (I-655)+(1.068)+(2.033), (I-655)+(1.068)+(2.034), (I-655)+(1.068)+(2.035), (I-655)+(1.068)+(2.036), (I-655)+(1.068)+(2.037), (I-655)+(1.068)+(2.038), (I-655)+(1.068)+(2.039), (I-655)+(1.068)+(2.040), (I-655)+(1.068)+(2.041), (I-655)+(1.068)+(2.042), (I-655)+(1.068)+(2.043), (I-655)+(1.068)+(2.044), (I-655)+(1.068)+(2.045), (I-655)+(1.068)+(2.046), (I-655)+(1.068)+(2.047), (I-655)+(1.068)+(2.048), (I-655)+(1.068)+(2.049), (I-655)+(1.068)+(2.050), (I-655)+(1.068)+(2.051), (I-655)+(1.068)+(2.052), (I-655)+(1.068)+(2.053), (I-655)+(1.068)+(2.054), (I-655)+(1.068)+(2.055), (I-655)+(1.068)+(2.056), (I-655)+(1.068)+(2.057), (I-655)+(1.068)+(2.058), (I-655)+(1.068)+(2.059), (I-655)+(1.068)+(3.001), (I-655)+(1.068)+(3.002), (I-655)+(1.068)+(3.003), (I-655)+(1.068)+(3.004), (I-655)+(1.068)+(3.005), (I-655)+(1.068)+(3.006), (I-655)+(1.068)+(3.007), (I-655)+(1.068)+(3.008), (I-655)+(1.068)+(3.009), (I-655)+(1.068)+(3.010), (I-655)+(1.068)+(3.011), (I-655)+(1.068)+(3.012), (I-655)+(1.068)+(3.013), (I-655)+(1.068)+(3.014), (I-655)+(1.068)+(3.015), (I-655)+(1.068)+(3.016), (I-655)+(1.068)+(3.017), (I-655)+(1.068)+(3.018), (I-655)+(1.068)+(3.019), (I-655)+(1.068)+(3.020), (I-655)+(1.068)+(3.021), (I-655)+(1.068)+(3.022), (I-655)+(1.068)+(3.023), (I-655)+(1.068)+(3.024), (I-655)+(1.068)+(3.025), (I-655)+(1.068)+(3.026), (I-655)+(1.068)+(3.027), (I-655)+(1.068)+(3.028), (I-655)+(1.068)+(3.029), (I-655)+(1.068)+(3.030), (I-655)+(1.068)+(3.031), (I-655)+(1.068)+(5.001), (I-655)+(1.068)+(5.002), (I-655)+(1.068)+(5.003), (I-655)+(1.068)+(5.004), (I-655)+(1.068)+(5.005), (I-655)+(1.068)+(5.006), (I-655)+(1.068)+(5.007), (I-655)+(1.068)+(5.008), (I-655)+(1.068)+(5.009), (I-655)+(1.068)+(5.010), (I-655)+(1.068)+(5.011), (I-655)+(1.068)+(5.012), (I-655)+(1.068)+(5.013), (I-655)+(1.068)+(5.014), (I-655)+(1.068)+(5.015), (I-655)+(1.068)+(5.016), (I-655)+(1.068)+(5.017), (I-655)+(1.068)+(5.018), (I-655)+(1.068)+(5.019), (I-655)+(1.068)+(5.020), (I-655)+(1.068)+(5.021), (I-655)+(1.068)+(5.022), (I-655)+(1.068)+(5.023), (I-655)+(1.068)+(6.001), (I-655)+(1.068)+(6.002), (I-655)+(1.068)+(6.003), (I-655)+(1.068)+(6.004), (I-655)+(1.068)+(7.001), (I-655)+(1.068)+(7.002), (I-655)+(1.068)+(7.003), (I-655)+(1.068)+(7.004), (I-655)+(1.068)+(7.005), (I-655)+(1.068)+(7.006), (I-655)+(1.068)+(9.001), (I-655)+(1.068)+(9.002), (I-655)+(1.068)+(9.003), (I-655)+(1.068)+(9.004), (I-655)+(1.068)+(9.005), (I-655)+(1.068)+(9.006), (I-655)+(1.068)+(9.007), (I-655)+(1.068)+(9.008), (I-655)+(1.068)+(9.009), (I-655)+(1.068)+(14.001), (I-655)+(1.068)+(14.002), (I-655)+(1.068)+(15.008), (I-655)+(1.068)+(15.011), (I-655)+(1.068)+(15.012), (I-655)+(1.068)+(15.016), (I-655)+(1.068)+(15.025), (I-655)+(1.068)+(15.027), (I-655)+(1.068)+(15.047), (I-655)+(1.068)+(15.063), (I-655)+(1.068)+(15.064), (I-655)+(1.068)+(16.001), (I-655)+(1.068)+(16.002), (I-655)+(1.068)+(16.003), (I-655)+(1.068)+(16.004), (I-655)+(1.068)+(16.005), (I-655)+(1.068)+(16.006), (I-655)+(1.068)+(16.007), (I-655)+(1.068)+(16.008), (I-655)+(1.068)+(17.001), (I-655)+(1.068)+(17.002), (I-655)+(1.068)+(17.003), (I-655)+(1.068)+(17.004), (I-655)+(1.068)+(17.005), (I-655)+(1.068)+(17.006), (I-655)+(1.068)+(17.007), (I-655)+(1.068)+(17.008), (I-655)+(1.068)+(17.009), (I-655)+(1.068)+(17.010), (I-655)+(1.068)+(17.011), (I-655)+(1.068)+(17.012), (I-655)+(1.068)+(18.001),

(I-655)+(1.069)+(1.070), (I-655)+(1.069)+(1.071), (I-655)+(1.069)+(1.072), (I-655)+(1.069)+(1.073), (I-655)+(1.069)+(1.074), (I-655)+(1.069)+(1.075), (I-655)+(1.069)+(1.076), (I-655)+(1.069)+(1.077), (I-655)+(1.069)+(1.078), (I-655)+(1.069)+(1.079), (I-655)+(1.069)+(1.080), (I-655)+(1.069)+(1.081), (I-655)+(1.069)+(1.082), (I-655)+(1.069)+(1.083), (I-655)+(1.069)+(1.084), (I-655)+(1.069)+(1.085), (I-655)+(1.069)+(1.086), (I-655)+(1.069)+(1.087), (I-655)+(1.069)+(1.088), (I-655)+(1.069)+(1.089), (I-655)+(1.069)+(1.090), (I-655)+(1.069)+(1.091), (I-655)+(1.069)+(1.092), (I-655)+(1.069)+(2.001), (I-655)+(1.069)+(2.002), (I-655)+(1.069)+(2.003), (I-655)+(1.069)+(2.004), (I-655)+(1.069)+(2.005), (I-655)+(1.069)+(2.006), (I-655)+(1.069)+(2.007), (I-655)+(1.069)+(2.008), (I-655)+(1.069)+(2.009), (I-655)+(1.069)+(2.010), (I-655)+(1.069)+(2.011), (I-655)+(1.069)+(2.012), (I-655)+(1.069)+(2.013), (I-655)+(1.069)+(2.014), (I-655)+(1.069)+(2.015), (I-655)+(1.069)+(2.016), (I-655)+(1.069)+(2.017), (I-655)+(1.069)+(2.018), (I-655)+(1.069)+(2.019), (I-655)+(1.069)+(2.020), (I-655)+(1.069)+(2.021), (I-655)+(1.069)+(2.022), (I-655)+(1.069)+(2.023), (I-655)+(1.069)+(2.024), (I-655)+(1.069)+(2.025), (I-655)+(1.069)+(2.026), (I-655)+(1.069)+(2.027), (I-655)+(1.069)+(2.028), (I-655)+(1.069)+(2.029), (I-655)+(1.069)+(2.030), (I-655)+(1.069)+(2.031), (I-655)+(1.069)+(2.032), (I-655)+(1.069)+(2.033), (I-655)+(1.069)+(2.034), (I-655)+(1.069)+(2.035), (I-655)+(1.069)+(2.036), (I-655)+(1.069)+(2.037), (I-655)+(1.069)+(2.038), (I-655)+(1.069)+(2.039), (I-655)+(1.069)+(2.040), (I-655)+(1.069)+(2.041), (I-655)+(1.069)+(2.042), (I-655)+(1.069)+(2.043), (I-655)+(1.069)+(2.044), (I-655)+(1.069)+(2.045), (I-655)+(1.069)+(2.046), (I-655)+(1.069)+(2.047), (I-655)+(1.069)+(2.048), (I-655)+(1.069)+(2.049), (I-655)+(1.069)+(2.050), (I-655)+(1.069)+(2.051), (I-655)+(1.069)+(2.052), (I-655)+(1.069)+(2.053), (I-655)+(1.069)+(2.054), (I-655)+(1.069)+(2.055), (I-655)+(1.069)+(2.056), (I-655)+(1.069)+(2.057), (I-655)+(1.069)+(2.058), (I-655)+(1.069)+(2.059), (I-655)+(1.069)+(3.001), (I-655)+(1.069)+(3.002), (I-655)+(1.069)+(3.003), (I-655)+(1.069)+(3.004), (I-655)+(1.069)+(3.005), (I-655)+(1.069)+(3.006), (I-655)+(1.069)+(3.007), (I-655)+(1.069)+(3.008), (I-655)+(1.069)+(3.009), (I-655)+(1.069)+(3.010), (I-655)+(1.069)+(3.011), (I-655)+(1.069)+(3.012), (I-655)+(1.069)+(3.013), (I-655)+(1.069)+(3.014), (I-655)+(1.069)+(3.015), (I-655)+(1.069)+(3.016), (I-655)+(1.069)+(3.017), (I-655)+(1.069)+(3.018), (I-655)+(1.069)+(3.019), (I-655)+(1.069)+(3.020), (I-655)+(1.069)+(3.021), (I-655)+(1.069)+(3.022), (I-655)+(1.069)+(3.023), (I-655)+(1.069)+(3.024), (I-655)+(1.069)+(3.025), (I-655)+(1.069)+(3.026), (I-655)+(1.069)+(3.027), (I-655)+(1.069)+(3.028), (I-655)+(1.069)+(3.029), (I-655)+(1.069)+(3.030), (I-655)+(1.069)+(3.031), (I-655)+(1.069)+(5.001), (I-655)+(1.069)+(5.002), (I-655)+(1.069)+(5.003), (I-655)+(1.069)+(5.004), (I-655)+(1.069)+(5.005), (I-655)+(1.069)+(5.006), (I-655)+(1.069)+(5.007), (I-655)+(1.069)+(5.008), (I-655)+(1.069)+(5.009), (I-655)+(1.069)+(5.010), (I-655)+(1.069)+(5.011), (I-655)+(1.069)+(5.012), (I-655)+(1.069)+(5.013), (I-655)+(1.069)+(5.014), (I-655)+(1.069)+(5.015), (I-655)+(1.069)+(5.016), (I-655)+(1.069)+(5.017), (I-655)+(1.069)+(5.018), (I-655)+(1.069)+(5.019), (I-655)+(1.069)+(5.020), (I-655)+(1.069)+(5.021), (I-655)+(1.069)+(5.022), (I-655)+(1.069)+(5.023), (I-655)+(1.069)+(6.001), (I-655)+(1.069)+(6.002), (I-655)+(1.069)+(6.003), (I-655)+(1.069)+(6.004), (I-655)+(1.069)+(7.001), (I-655)+(1.069)+(7.002), (I-655)+(1.069)+(7.003), (I-655)+(1.069)+(7.004), (I-655)+(1.069)+(7.005), (I-655)+(1.069)+(7.006), (I-655)+(1.069)+(9.001), (I-655)+(1.069)+(9.002), (I-655)+(1.069)+(9.003), (I-655)+(1.069)+(9.004), (I-655)+(1.069)+(9.005), (I-655)+(1.069)+(9.006), (I-655)+(1.069)+(9.007), (I-655)+(1.069)+(9.008), (I-655)+(1.069)+(9.009), (I-655)+(1.069)+(14.001), (I-655)+(1.069)+(14.002), (I-655)+(1.069)+(15.008), (I-655)+(1.069)+(15.011), (I-655)+(1.069)+(15.012), (I-655)+(1.069)+(15.016), (I-655)+(1.069)+(15.025), (I-655)+(1.069)+(15.027), (I-655)+(1.069)+(15.047), (I-655)+(1.069)+(15.063), (I-655)+(1.069)+(15.064), (I-655)+(1.069)+(16.001), (I-655)+(1.069)+(16.002), (I-655)+(1.069)+(16.003), (I-655)+(1.069)+(16.004), (I-655)+(1.069)+(16.005), (I-655)+(1.069)+(16.006), (I-655)+(1.069)+(16.007), (I-655)+(1.069)+(16.008), (I-655)+(1.069)+(17.001), (I-655)+(1.069)+(17.002), (I-655)+(1.069)+(17.003), (I-655)+(1.069)+(17.004), (I-655)+(1.069)+(17.005), (I-655)+(1.069)+(17.006), (I-655)+(1.069)+(17.007), (I-655)+(1.069)+(17.008), (I-655)+(1.069)+(17.009), (I-655)+(1.069)+(17.010), (I-655)+(1.069)+(17.011), (I-655)+(1.069)+(17.012), (I-655)+(1.069)+(18.001),

(I-655)+(1.070)+(1.071), (I-655)+(1.070)+(1.072), (I-655)+(1.070)+(1.073), (I-655)+(1.070)+(1.074), (I-655)+(1.070)+(1.075), (I-655)+(1.070)+(1.076), (I-655)+(1.070)+(1.077), (I-655)+(1.070)+(1.078), (I-655)+(1.070)+(1.079), (I-655)+(1.070)+(1.080), (I-655)+(1.070)+(1.081), (I-655)+(1.070)+(1.082), (I-655)+(1.070)+(1.083), (I-655)+(1.070)+(1.084), (I-655)+(1.070)+(1.085), (I-655)+(1.070)+(1.086), (I-655)+(1.070)+(1.087), (I-655)+(1.070)+(1.088), (I-655)+(1.070)+(1.089), (I-655)+(1.070)+(1.090), (I-655)+(1.070)+(1.091), (I-655)+(1.070)+(1.092), (I-655)+(1.070)+(2.001), (I-655)+(1.070)+(2.002), (I-655)+(1.070)+(2.003), (I-655)+(1.070)+(2.004), (I-655)+(1.070)+(2.005), (I-655)+(1.070)+(2.006), (I-655)+(1.070)+(2.007), (I-655)+(1.070)+(2.008), (I-655)+(1.070)+(2.009), (I-655)+(1.070)+(2.010), (I-655)+(1.070)+(2.011), (I-655)+(1.070)+(2.012), (I-655)+(1.070)+(2.013), (I-655)+(1.070)+(2.014), (I-655)+(1.070)+(2.015), (I-655)+(1.070)+(2.016), (I-655)+(1.070)+(2.017), (I-655)+(1.070)+(2.018), (I-655)+(1.070)+(2.019), (I-655)+(1.070)+(2.020), (I-655)+(1.070)+(2.021), (I-655)+(1.070)+(2.022), (I-655)+(1.070)+(2.023), (I-655)+(1.070)+(2.024), (I-655)+(1.070)+(2.025), (I-655)+(1.070)+(2.026), (I-655)+(1.070)+(2.027), (I-655)+(1.070)+(2.028), (I-655)+(1.070)+(2.029), (I-655)+(1.070)+(2.030), (I-655)+(1.070)+(2.031), (I-655)+(1.070)+(2.032), (I-655)+(1.070)+(2.033), (I-655)+(1.070)+(2.034), (I-655)+(1.070)+(2.035), (I-655)+(1.070)+(2.036), (I-655)+(1.070)+(2.037), (I-655)+(1.070)+(2.038), (I-655)+(1.070)+(2.039), (I-655)+(1.070)+(2.040), (I-655)+(1.070)+(2.041), (I-655)+(1.070)+(2.042), (I-655)+(1.070)+(2.043), (I-655)+(1.070)+(2.044), (I-655)+(1.070)+(2.045), (I-655)+(1.070)+(2.046), (I-655)+(1.070)+(2.047), (I-655)+(1.070)+(2.048), (I-655)+(1.070)+(2.049), (I-655)+(1.070)+(2.050), (I-655)+(1.070)+(2.051), (I-655)+(1.070)+(2.052), (I-655)+(1.070)+(2.053), (I-655)+(1.070)+(2.054), (I-655)+(1.070)+(2.055), (I-655)+(1.070)+(2.056), (I-655)+(1.070)+(2.057), (I-655)+(1.070)+(2.058), (I-655)+(1.070)+(2.059), (I-655)+(1.070)+(3.001), (I-655)+(1.070)+(3.002), (I-655)+(1.070)+(3.003), (I-655)+(1.070)+(3.004), (I-655)+(1.070)+(3.005), (I-655)+(1.070)+(3.006), (I-655)+(1.070)+(3.007), (I-655)+(1.070)+(3.008), (I-655)+(1.070)+(3.009), (I-655)+(1.070)+(3.010), (I-655)+(1.070)+(3.011), (I-655)+(1.070)+(3.012), (I-655)+(1.070)+(3.013), (I-655)+(1.070)+(3.014), (I-655)+(1.070)+(3.015), (I-655)+(1.070)+(3.016), (I-655)+(1.070)+(3.017), (I-655)+(1.070)+(3.018), (I-655)+(1.070)+(3.019), (I-655)+(1.070)+(3.020), (I-655)+(1.070)+(3.021), (I-655)+(1.070)+(3.022), (I-655)+(1.070)+(3.023), (I-655)+(1.070)+(3.024), (I-655)+(1.070)+(3.025), (I-655)+(1.070)+(3.026), (I-655)+(1.070)+(3.027), (I-655)+(1.070)+(3.028), (I-655)+(1.070)+(3.029), (I-655)+(1.070)+(3.030), (I-655)+(1.070)+(3.031), (I-655)+(1.070)+(5.001), (I-655)+(1.070)+(5.002), (I-655)+(1.070)+(5.003), (I-655)+(1.070)+(5.004), (I-655)+(1.070)+(5.005), (I-655)+(1.070)+(5.006), (I-655)+(1.070)+(5.007), (I-655)+(1.070)+(5.008), (I-655)+(1.070)+(5.009), (I-655)+(1.070)+(5.010), (I-655)+(1.070)+(5.011), (I-655)+(1.070)+(5.012), (I-655)+(1.070)+(5.013), (I-655)+(1.070)+(5.014), (I-655)+(1.070)+(5.015), (I-655)+(1.070)+(5.016), (I-655)+(1.070)+(5.017), (I-655)+(1.070)+(5.018), (I-655)+(1.070)+(5.019), (I-655)+(1.070)+(5.020), (I-655)+(1.070)+(5.021), (I-655)+(1.070)+(5.022), (I-655)+(1.070)+(5.023), (I-655)+(1.070)+(6.001), (I-655)+(1.070)+(6.002), (I-655)+(1.070)+(6.003), (I-655)+(1.070)+(6.004), (I-655)+(1.070)+(7.001), (I-655)+(1.070)+(7.002), (I-655)+(1.070)+(7.003), (I-655)+(1.070)+(7.004), (I-655)+(1.070)+(7.005), (I-655)+(1.070)+(7.006), (I-655)+(1.070)+(9.001), (I-655)+(1.070)+(9.002), (I-655)+(1.070)+(9.003), (I-655)+(1.070)+(9.004), (I-655)+(1.070)+(9.005), (I-655)+(1.070)+(9.006), (I-655)+(1.070)+(9.007), (I-655)+(1.070)+(9.008), (I-655)+(1.070)+(9.009), (I-655)+(1.070)+(14.001), (I-655)+(1.070)+(14.002), (I-655)+(1.070)+(15.008), (I-655)+(1.070)+(15.011), (I-655)+(1.070)+(15.012), (I-655)+(1.070)+(15.016), (I-655)+(1.070)+(15.025), (I-655)+(1.070)+(15.027), (I-655)+(1.070)+(15.047), (I-655)+(1.070)+(15.063), (I-655)+(1.070)+(15.064), (I-655)+(1.070)+(16.001), (I-655)+(1.070)+(16.002), (I-655)+(1.070)+(16.003), (I-655)+(1.070)+(16.004), (I-655)+(1.070)+(16.005), (I-655)+(1.070)+(16.006), (I-655)+(1.070)+(16.007), (I-655)+(1.070)+(16.008), (I-655)+(1.070)+(17.001), (I-655)+(1.070)+(17.002), (I-655)+(1.070)+(17.003), (I-655)+(1.070)+(17.004), (I-655)+(1.070)+(17.005), (I-655)+(1.070)+(17.006), (I-655)+(1.070)+(17.007), (I-655)+(1.070)+(17.008), (I-655)+(1.070)+(17.009), (I-655)+(1.070)+(17.010), (I-655)+(1.070)+(17.011), (I-655)+(1.070)+(17.012), (I-655)+(1.070)+(18.001),

(I-655)+(1.071)+(1.072), (I-655)+(1.071)+(1.073), (I-655)+(1.071)+(1.074), (I-655)+(1.071)+(1.075), (I-655)+(1.071)+(1.076), (I-655)+(1.071)+(1.077), (I-655)+(1.071)+(1.078), (I-655)+(1.071)+(1.079), (I-655)+(1.071)+(1.080), (I-655)+(1.071)+(1.081), (I-655)+(1.071)+(1.082), (I-655)+(1.071)+(1.083), (I-655)+(1.071)+(1.084), (I-655)+(1.071)+(1.085), (I-655)+(1.071)+(1.086), (I-655)+(1.071)+(1.087), (I-655)+(1.071)+(1.088), (I-655)+(1.071)+(1.089), (I-655)+(1.071)+(1.090), (I-655)+(1.071)+(1.091), (I-655)+(1.071)+(1.092), (I-655)+(1.071)+(2.001), (I-655)+(1.071)+(2.002), (I-655)+(1.071)+(2.003), (I-655)+(1.071)+(2.004), (I-655)+(1.071)+(2.005), (I-655)+(1.071)+(2.006), (I-655)+(1.071)+(2.007), (I-655)+(1.071)+(2.008), (I-655)+(1.071)+(2.009), (I-655)+(1.071)+(2.010), (I-655)+(1.071)+(2.011), (I-655)+(1.071)+(2.012), (I-655)+(1.071)+(2.013), (I-655)+(1.071)+(2.014), (I-655)+(1.071)+(2.015), (I-655)+(1.071)+(2.016), (I-655)+(1.071)+(2.017), (I-655)+(1.071)+(2.018), (I-655)+(1.071)+(2.019), (I-655)+(1.071)+(2.020), (I-655)+(1.071)+(2.021), (I-655)+(1.071)+(2.022), (I-655)+(1.071)+(2.023), (I-655)+(1.071)+(2.024), (I-655)+(1.071)+(2.025), (I-655)+(1.071)+(2.026), (I-655)+(1.071)+(2.027), (I-655)+(1.071)+(2.028), (I-655)+(1.071)+(2.029), (I-655)+(1.071)+(2.030), (I-655)+(1.071)+(2.031), (I-655)+(1.071)+(2.032), (I-655)+(1.071)+(2.033), (I-655)+(1.071)+(2.034), (I-655)+(1.071)+(2.035), (I-655)+(1.071)+(2.036), (I-655)+(1.071)+(2.037), (I-655)+(1.071)+(2.038), (I-655)+(1.071)+(2.039), (I-655)+(1.071)+(2.040), (I-655)+(1.071)+(2.041), (I-655)+(1.071)+(2.042), (I-655)+(1.071)+(2.043), (I-655)+(1.071)+(2.044), (I-655)+(1.071)+(2.045), (I-655)+(1.071)+(2.046), (I-655)+(1.071)+(2.047), (I-655)+(1.071)+(2.048), (I-655)+(1.071)+(2.049), (I-655)+(1.071)+(2.050), (I-655)+(1.071)+(2.051), (I-655)+(1.071)+(2.052), (I-655)+(1.071)+(2.053), (I-655)+(1.071)+(2.054), (I-655)+(1.071)+(2.055), (I-655)+(1.071)+(2.056), (I-655)+(1.071)+(2.057), (I-655)+(1.071)+(2.058), (I-655)+(1.071)+(2.059), (I-655)+(1.071)+(3.001), (I-655)+(1.071)+(3.002), (I-655)+(1.071)+(3.003), (I-655)+(1.071)+(3.004), (I-655)+(1.071)+(3.005), (I-655)+(1.071)+(3.006), (I-655)+(1.071)+(3.007), (I-655)+(1.071)+(3.008), (I-655)+(1.071)+(3.009), (I-655)+(1.071)+(3.010), (I-655)+(1.071)+(3.011), (I-655)+(1.071)+(3.012), (I-655)+(1.071)+(3.013), (I-655)+(1.071)+(3.014), (I-655)+(1.071)+(3.015), (I-655)+(1.071)+(3.016), (I-655)+(1.071)+(3.017), (I-655)+(1.071)+(3.018), (I-655)+(1.071)+(3.019), (I-655)+(1.071)+(3.020), (I-655)+(1.071)+(3.021), (I-655)+(1.071)+(3.022), (I-655)+(1.071)+(3.023), (I-655)+(1.071)+(3.024), (I-655)+(1.071)+(3.025), (I-655)+(1.071)+(3.026), (I-655)+(1.071)+(3.027), (I-655)+(1.071)+(3.028), (I-655)+(1.071)+(3.029), (I-655)+(1.071)+(3.030), (I-655)+(1.071)+(3.031), (I-655)+(1.071)+(5.001), (I-655)+(1.071)+(5.002), (I-655)+(1.071)+(5.003), (I-655)+(1.071)+(5.004), (I-655)+(1.071)+(5.005), (I-655)+(1.071)+(5.006), (I-655)+(1.071)+(5.007), (I-655)+(1.071)+(5.008), (I-655)+(1.071)+(5.009), (I-655)+(1.071)+(5.010), (I-655)+(1.071)+(5.011), (I-655)+(1.071)+(5.012), (I-655)+(1.071)+(5.013), (I-655)+(1.071)+(5.014), (I-655)+(1.071)+(5.015), (I-655)+(1.071)+(5.016), (I-655)+(1.071)+(5.017), (I-655)+(1.071)+(5.018), (I-655)+(1.071)+(5.019), (I-655)+(1.071)+(5.020), (I-655)+(1.071)+(5.021), (I-655)+(1.071)+(5.022), (I-655)+(1.071)+(5.023), (I-655)+(1.071)+(6.001), (I-655)+(1.071)+(6.002), (I-655)+(1.071)+(6.003), (I-655)+(1.071)+(6.004), (I-655)+(1.071)+(7.001), (I-655)+(1.071)+(7.002), (I-655)+(1.071)+(7.003), (I-655)+(1.071)+(7.004), (I-655)+(1.071)+(7.005), (I-655)+(1.071)+(7.006), (I-655)+(1.071)+(9.001), (I-655)+(1.071)+(9.002), (I-655)+(1.071)+(9.003), (I-655)+(1.071)+(9.004), (I-655)+(1.071)+(9.005), (I-655)+(1.071)+(9.006), (I-655)+(1.071)+(9.007), (I-655)+(1.071)+(9.008), (I-655)+(1.071)+(9.009), (I-655)+(1.071)+(14.001), (I-655)+(1.071)+(14.002), (I-655)+(1.071)+(15.008), (I-655)+(1.071)+(15.011), (I-655)+(1.071)+(15.012), (I-655)+(1.071)+(15.016), (I-655)+(1.071)+(15.025), (I-655)+(1.071)+(15.027), (I-655)+(1.071)+(15.047), (I-655)+(1.071)+(15.063), (I-655)+(1.071)+(15.064), (I-655)+(1.071)+(16.001), (I-655)+(1.071)+(16.002), (I-655)+(1.071)+(16.003), (I-655)+(1.071)+(16.004), (I-655)+(1.071)+(16.005), (I-655)+(1.071)+(16.006), (I-655)+(1.071)+(16.007), (I-655)+(1.071)+(16.008), (I-655)+(1.071)+(17.001), (I-655)+(1.071)+(17.002), (I-655)+(1.071)+(17.003), (I-655)+(1.071)+(17.004), (I-655)+(1.071)+(17.005), (I-655)+(1.071)+(17.006), (I-655)+(1.071)+(17.007), (I-655)+(1.071)+(17.008), (I-655)+(1.071)+(17.009), (I-655)+(1.071)+(17.010), (I-655)+(1.071)+(17.011), (I-655)+(1.071)+(17.012), (I-655)+(1.071)+(18.001),

(I-655)+(1.072)+(1.073), (I-655)+(1.072)+(1.074), (I-655)+(1.072)+(1.075), (I-655)+(1.072)+(1.076), (I-655)+(1.072)+(1.077), (I-655)+(1.072)+(1.078), (I-655)+(1.072)+(1.079), (I-655)+(1.072)+(1.080), (I-655)+(1.072)+(1.081), (I-655)+(1.072)+(1.082), (I-655)+(1.072)+(1.083), (I-655)+(1.072)+(1.084), (I-655)+(1.072)+(1.085), (I-655)+(1.072)+(1.086), (I-655)+(1.072)+(1.087), (I-655)+(1.072)+(1.088), (I-655)+(1.072)+(1.089), (I-655)+(1.072)+(1.090), (I-655)+(1.072)+(1.091), (I-655)+(1.072)+(1.092), (I-655)+(1.072)+(2.001), (I-655)+(1.072)+(2.002), (I-655)+(1.072)+(2.003), (I-655)+(1.072)+(2.004), (I-655)+(1.072)+(2.005), (I-655)+(1.072)+(2.006), (I-655)+(1.072)+(2.007), (I-655)+(1.072)+(2.008), (I-655)+(1.072)+(2.009), (I-655)+(1.072)+(2.010), (I-655)+(1.072)+(2.011), (I-655)+(1.072)+(2.012), (I-655)+(1.072)+(2.013), (I-655)+(1.072)+(2.014), (I-655)+(1.072)+(2.015), (I-655)+(1.072)+(2.016), (I-655)+(1.072)+(2.017), (I-655)+(1.072)+(2.018), (I-655)+(1.072)+(2.019), (I-655)+(1.072)+(2.020), (I-655)+(1.072)+(2.021), (I-655)+(1.072)+(2.022), (I-655)+(1.072)+(2.023), (I-655)+(1.072)+(2.024), (I-655)+(1.072)+(2.025), (I-655)+(1.072)+(2.026), (I-655)+(1.072)+(2.027), (I-655)+(1.072)+(2.028), (I-655)+(1.072)+(2.029), (I-655)+(1.072)+(2.030), (I-655)+(1.072)+(2.031), (I-655)+(1.072)+(2.032), (I-655)+(1.072)+(2.033), (I-655)+(1.072)+(2.034), (I-655)+(1.072)+(2.035), (I-655)+(1.072)+(2.036), (I-655)+(1.072)+(2.037), (I-655)+(1.072)+(2.038), (I-655)+(1.072)+(2.039), (I-655)+(1.072)+(2.040), (I-655)+(1.072)+(2.041), (I-655)+(1.072)+(2.042), (I-655)+(1.072)+(2.043), (I-655)+(1.072)+(2.044), (I-655)+(1.072)+(2.045), (I-655)+(1.072)+(2.046), (I-655)+(1.072)+(2.047), (I-655)+(1.072)+(2.048), (I-655)+(1.072)+(2.049), (I-655)+(1.072)+(2.050), (I-655)+(1.072)+(2.051), (I-655)+(1.072)+(2.052), (I-655)+(1.072)+(2.053), (I-655)+(1.072)+(2.054), (I-655)+(1.072)+(2.055), (I-655)+(1.072)+(2.056), (I-655)+(1.072)+(2.057), (I-655)+(1.072)+(2.058), (I-655)+(1.072)+(2.059), (I-655)+(1.072)+(3.001), (I-655)+(1.072)+(3.002), (I-655)+(1.072)+(3.003), (I-655)+(1.072)+(3.004), (I-655)+(1.072)+(3.005), (I-655)+(1.072)+(3.006), (I-655)+(1.072)+(3.007), (I-655)+(1.072)+(3.008), (I-655)+(1.072)+(3.009), (I-655)+(1.072)+(3.010), (I-655)+(1.072)+(3.011), (I-655)+(1.072)+(3.012), (I-655)+(1.072)+(3.013), (I-655)+(1.072)+(3.014), (I-655)+(1.072)+(3.015), (I-655)+(1.072)+(3.016), (I-655)+(1.072)+(3.017), (I-655)+(1.072)+(3.018), (I-655)+(1.072)+(3.019), (I-655)+(1.072)+(3.020), (I-655)+(1.072)+(3.021), (I-655)+(1.072)+(3.022), (I-655)+(1.072)+(3.023), (I-655)+(1.072)+(3.024), (I-655)+(1.072)+(3.025), (I-655)+(1.072)+(3.026), (I-655)+(1.072)+(3.027), (I-655)+(1.072)+(3.028), (I-655)+(1.072)+(3.029), (I-655)+(1.072)+(3.030), (I-655)+(1.072)+(3.031), (I-655)+(1.072)+(5.001), (I-655)+(1.072)+(5.002), (I-655)+(1.072)+(5.003), (I-655)+(1.072)+(5.004), (I-655)+(1.072)+(5.005), (I-655)+(1.072)+(5.006), (I-655)+(1.072)+(5.007), (I-655)+(1.072)+(5.008), (I-655)+(1.072)+(5.009), (I-655)+(1.072)+(5.010), (I-655)+(1.072)+(5.011), (I-655)+(1.072)+(5.012), (I-655)+(1.072)+(5.013), (I-655)+(1.072)+(5.014), (I-655)+(1.072)+(5.015), (I-655)+(1.072)+(5.016), (I-655)+(1.072)+(5.017), (I-655)+(1.072)+(5.018), (I-655)+(1.072)+(5.019), (I-655)+(1.072)+(5.020), (I-655)+(1.072)+(5.021), (I-655)+(1.072)+(5.022), (I-655)+(1.072)+(5.023), (I-655)+(1.072)+(6.001), (I-655)+(1.072)+(6.002), (I-655)+(1.072)+(6.003), (I-655)+(1.072)+(6.004), (I-655)+(1.072)+(7.001), (I-655)+(1.072)+(7.002), (I-655)+(1.072)+(7.003), (I-655)+(1.072)+(7.004), (I-655)+(1.072)+(7.005), (I-655)+(1.072)+(7.006), (I-655)+(1.072)+(9.001), (I-655)+(1.072)+(9.002), (I-655)+(1.072)+(9.003), (I-655)+(1.072)+(9.004), (I-655)+(1.072)+(9.005), (I-655)+(1.072)+(9.006), (I-655)+(1.072)+(9.007), (I-655)+(1.072)+(9.008), (I-655)+(1.072)+(9.009), (I-655)+(1.072)+(14.001), (I-655)+(1.072)+(14.002), (I-655)+(1.072)+(15.008), (I-655)+(1.072)+(15.011), (I-655)+(1.072)+(15.012), (I-655)+(1.072)+(15.016), (I-655)+(1.072)+(15.025), (I-655)+(1.072)+(15.027), (I-655)+(1.072)+(15.047), (I-655)+(1.072)+(15.063), (I-655)+(1.072)+(15.064), (I-655)+(1.072)+(16.001), (I-655)+(1.072)+(16.002), (I-655)+(1.072)+(16.003), (I-655)+(1.072)+(16.004), (I-655)+(1.072)+(16.005), (I-655)+(1.072)+(16.006), (I-655)+(1.072)+(16.007), (I-655)+(1.072)+(16.008), (I-655)+(1.072)+(17.001), (I-655)+(1.072)+(17.002), (I-655)+(1.072)+(17.003), (I-655)+(1.072)+(17.004), (I-655)+(1.072)+(17.005), (I-655)+(1.072)+(17.006), (I-655)+(1.072)+(17.007), (I-655)+(1.072)+(17.008), (I-655)+(1.072)+(17.009), (I-655)+(1.072)+(17.010), (I-655)+(1.072)+(17.011), (I-655)+(1.072)+(17.012), (I-655)+(1.072)+(18.001),

(I-655)+(1.073)+(1.074), (I-655)+(1.073)+(1.075), (I-655)+(1.073)+(1.076), (I-655)+(1.073)+(1.077), (I-655)+(1.073)+(1.078), (I-655)+(1.073)+(1.079), (I-655)+(1.073)+(1.080), (I-655)+(1.073)+(1.081), (I-655)+(1.073)+(1.082), (I-655)+(1.073)+(1.083), (I-655)+(1.073)+(1.084), (I-655)+(1.073)+(1.085), (I-655)+(1.073)+(1.086), (I-655)+(1.073)+(1.087), (I-655)+(1.073)+(1.088), (I-655)+(1.073)+(1.089), (I-655)+(1.073)+(1.090), (I-655)+(1.073)+(1.091), (I-655)+(1.073)+(1.092), (I-655)+(1.073)+(2.001), (I-655)+(1.073)+(2.002), (I-655)+(1.073)+(2.003), (I-655)+(1.073)+(2.004), (I-655)+(1.073)+(2.005), (I-655)+(1.073)+(2.006), (I-655)+(1.073)+(2.007), (I-655)+(1.073)+(2.008), (I-655)+(1.073)+(2.009), (I-655)+(1.073)+(2.010), (I-655)+(1.073)+(2.011), (I-655)+(1.073)+(2.012), (I-655)+(1.073)+(2.013), (I-655)+(1.073)+(2.014), (I-655)+(1.073)+(2.015), (I-655)+(1.073)+(2.016), (I-655)+(1.073)+(2.017), (I-655)+(1.073)+(2.018), (I-655)+(1.073)+(2.019), (I-655)+(1.073)+(2.020), (I-655)+(1.073)+(2.021), (I-655)+(1.073)+(2.022), (I-655)+(1.073)+(2.023), (I-655)+(1.073)+(2.024), (I-655)+(1.073)+(2.025), (I-655)+(1.073)+(2.026), (I-655)+(1.073)+(2.027), (I-655)+(1.073)+(2.028), (I-655)+(1.073)+(2.029), (I-655)+(1.073)+(2.030), (I-655)+(1.073)+(2.031), (I-655)+(1.073)+(2.032), (I-655)+(1.073)+(2.033), (I-655)+(1.073)+(2.034), (I-655)+(1.073)+(2.035), (I-655)+(1.073)+(2.036), (I-655)+(1.073)+(2.037), (I-655)+(1.073)+(2.038), (I-655)+(1.073)+(2.039), (I-655)+(1.073)+(2.040), (I-655)+(1.073)+(2.041), (I-655)+(1.073)+(2.042), (I-655)+(1.073)+(2.043), (I-655)+(1.073)+(2.044), (I-655)+(1.073)+(2.045), (I-655)+(1.073)+(2.046), (I-655)+(1.073)+(2.047), (I-655)+(1.073)+(2.048), (I-655)+(1.073)+(2.049), (I-655)+(1.073)+(2.050), (I-655)+(1.073)+(2.051), (I-655)+(1.073)+(2.052), (I-655)+(1.073)+(2.053), (I-655)+(1.073)+(2.054), (I-655)+(1.073)+(2.055), (I-655)+(1.073)+(2.056), (I-655)+(1.073)+(2.057), (I-655)+(1.073)+(2.058), (I-655)+(1.073)+(2.059), (I-655)+(1.073)+(3.001), (I-655)+(1.073)+(3.002), (I-655)+(1.073)+(3.003), (I-655)+(1.073)+(3.004), (I-655)+(1.073)+(3.005), (I-655)+(1.073)+(3.006), (I-655)+(1.073)+(3.007), (I-655)+(1.073)+(3.008), (I-655)+(1.073)+(3.009), (I-655)+(1.073)+(3.010), (I-655)+(1.073)+(3.011), (I-655)+(1.073)+(3.012), (I-655)+(1.073)+(3.013), (I-655)+(1.073)+(3.014), (I-655)+(1.073)+(3.015), (I-655)+(1.073)+(3.016), (I-655)+(1.073)+(3.017), (I-655)+(1.073)+(3.018), (I-655)+(1.073)+(3.019), (I-655)+(1.073)+(3.020), (I-655)+(1.073)+(3.021), (I-655)+(1.073)+(3.022), (I-655)+(1.073)+(3.023), (I-655)+(1.073)+(3.024), (I-655)+(1.073)+(3.025), (I-655)+(1.073)+(3.026), (I-655)+(1.073)+(3.027), (I-655)+(1.073)+(3.028), (I-655)+(1.073)+(3.029), (I-655)+(1.073)+(3.030), (I-655)+(1.073)+(3.031), (I-655)+(1.073)+(5.001), (I-655)+(1.073)+(5.002), (I-655)+(1.073)+(5.003), (I-655)+(1.073)+(5.004), (I-655)+(1.073)+(5.005), (I-655)+(1.073)+(5.006), (I-655)+(1.073)+(5.007), (I-655)+(1.073)+(5.008), (I-655)+(1.073)+(5.009), (I-655)+(1.073)+(5.010), (I-655)+(1.073)+(5.011), (I-655)+(1.073)+(5.012), (I-655)+(1.073)+(5.013), (I-655)+(1.073)+(5.014), (I-655)+(1.073)+(5.015), (I-655)+(1.073)+(5.016), (I-655)+(1.073)+(5.017), (I-655)+(1.073)+(5.018), (I-655)+(1.073)+(5.019), (I-655)+(1.073)+(5.020), (I-655)+(1.073)+(5.021), (I-655)+(1.073)+(5.022), (I-655)+(1.073)+(5.023), (I-655)+(1.073)+(6.001), (I-655)+(1.073)+(6.002), (I-655)+(1.073)+(6.003), (I-655)+(1.073)+(6.004), (I-655)+(1.073)+(7.001), (I-655)+(1.073)+(7.002), (I-655)+(1.073)+(7.003), (I-655)+(1.073)+(7.004), (I-655)+(1.073)+(7.005), (I-655)+(1.073)+(7.006), (I-655)+(1.073)+(9.001), (I-655)+(1.073)+(9.002), (I-655)+(1.073)+(9.003), (I-655)+(1.073)+(9.004), (I-655)+(1.073)+(9.005), (I-655)+(1.073)+(9.006), (I-655)+(1.073)+(9.007), (I-655)+(1.073)+(9.008), (I-655)+(1.073)+(9.009), (I-655)+(1.073)+(14.001), (I-655)+(1.073)+(14.002), (I-655)+(1.073)+(15.008), (I-655)+(1.073)+(15.011), (I-655)+(1.073)+(15.012), (I-655)+(1.073)+(15.016), (I-655)+(1.073)+(15.025), (I-655)+(1.073)+(15.027), (I-655)+(1.073)+(15.047), (I-655)+(1.073)+(15.063), (I-655)+(1.073)+(15.064), (I-655)+(1.073)+(16.001), (I-655)+(1.073)+(16.002), (I-655)+(1.073)+(16.003), (I-655)+(1.073)+(16.004), (I-655)+(1.073)+(16.005), (I-655)+(1.073)+(16.006), (I-655)+(1.073)+(16.007), (I-655)+(1.073)+(16.008), (I-655)+(1.073)+(17.001), (I-655)+(1.073)+(17.002), (I-655)+(1.073)+(17.003), (I-655)+(1.073)+(17.004), (I-655)+(1.073)+(17.005), (I-655)+(1.073)+(17.006), (I-655)+(1.073)+(17.007), (I-655)+(1.073)+(17.008), (I-655)+(1.073)+(17.009), (I-655)+(1.073)+(17.010), (I-655)+(1.073)+(17.011), (I-655)+(1.073)+(17.012), (I-655)+(1.073)+(18.001),

(I-655)+(1.074)+(1.075), (I-655)+(1.074)+(1.076), (I-655)+(1.074)+(1.077), (I-655)+(1.074)+(1.078), (I-655)+(1.074)+(1.079), (I-655)+(1.074)+(1.080), (I-655)+(1.074)+(1.081), (I-655)+(1.074)+(1.082), (I-655)+(1.074)+(1.083), (I-655)+(1.074)+(1.084), (I-655)+(1.074)+(1.085), (I-655)+(1.074)+(1.086), (I-655)+(1.074)+(1.087), (I-655)+(1.074)+(1.088), (I-655)+(1.074)+(1.089), (I-655)+(1.074)+(1.090), (I-655)+(1.074)+(1.091), (I-655)+(1.074)+(1.092), (I-655)+(1.074)+(2.001), (I-655)+(1.074)+(2.002), (I-655)+(1.074)+(2.003), (I-655)+(1.074)+(2.004), (I-655)+(1.074)+(2.005), (I-655)+(1.074)+(2.006), (I-655)+(1.074)+(2.007), (I-655)+(1.074)+(2.008), (I-655)+(1.074)+(2.009), (I-655)+(1.074)+(2.010), (I-655)+(1.074)+(2.011), (I-655)+(1.074)+(2.012), (I-655)+(1.074)+(2.013), (I-655)+(1.074)+(2.014), (I-655)+(1.074)+(2.015), (I-655)+(1.074)+(2.016), (I-655)+(1.074)+(2.017), (I-655)+(1.074)+(2.018), (I-655)+(1.074)+(2.019), (I-655)+(1.074)+(2.020), (I-655)+(1.074)+(2.021), (I-655)+(1.074)+(2.022), (I-655)+(1.074)+(2.023), (I-655)+(1.074)+(2.024), (I-655)+(1.074)+(2.025), (I-655)+(1.074)+(2.026), (I-655)+(1.074)+(2.027), (I-655)+(1.074)+(2.028), (I-655)+(1.074)+(2.029), (I-655)+(1.074)+(2.030), (I-655)+(1.074)+(2.031), (I-655)+(1.074)+(2.032), (I-655)+(1.074)+(2.033), (I-655)+(1.074)+(2.034), (I-655)+(1.074)+(2.035), (I-655)+(1.074)+(2.036), (I-655)+(1.074)+(2.037), (I-655)+(1.074)+(2.038), (I-655)+(1.074)+(2.039), (I-655)+(1.074)+(2.040), (I-655)+(1.074)+(2.041), (I-655)+(1.074)+(2.042), (I-655)+(1.074)+(2.043), (I-655)+(1.074)+(2.044), (I-655)+(1.074)+(2.045), (I-655)+(1.074)+(2.046), (I-655)+(1.074)+(2.047), (I-655)+(1.074)+(2.048), (I-655)+(1.074)+(2.049), (I-655)+(1.074)+(2.050), (I-655)+(1.074)+(2.051), (I-655)+(1.074)+(2.052), (I-655)+(1.074)+(2.053), (I-655)+(1.074)+(2.054), (I-655)+(1.074)+(2.055), (I-655)+(1.074)+(2.056), (I-655)+(1.074)+(2.057), (I-655)+(1.074)+(2.058), (I-655)+(1.074)+(2.059), (I-655)+(1.074)+(3.001), (I-655)+(1.074)+(3.002), (I-655)+(1.074)+(3.003), (I-655)+(1.074)+(3.004), (I-655)+(1.074)+(3.005), (I-655)+(1.074)+(3.006), (I-655)+(1.074)+(3.007), (I-655)+(1.074)+(3.008), (I-655)+(1.074)+(3.009), (I-655)+(1.074)+(3.010), (I-655)+(1.074)+(3.011), (I-655)+(1.074)+(3.012), (I-655)+(1.074)+(3.013), (I-655)+(1.074)+(3.014), (I-655)+(1.074)+(3.015), (I-655)+(1.074)+(3.016), (I-655)+(1.074)+(3.017), (I-655)+(1.074)+(3.018), (I-655)+(1.074)+(3.019), (I-655)+(1.074)+(3.020), (I-655)+(1.074)+(3.021), (I-655)+(1.074)+(3.022), (I-655)+(1.074)+(3.023), (I-655)+(1.074)+(3.024), (I-655)+(1.074)+(3.025), (I-655)+(1.074)+(3.026), (I-655)+(1.074)+(3.027), (I-655)+(1.074)+(3.028), (I-655)+(1.074)+(3.029), (I-655)+(1.074)+(3.030), (I-655)+(1.074)+(3.031), (I-655)+(1.074)+(5.001), (I-655)+(1.074)+(5.002), (I-655)+(1.074)+(5.003), (I-655)+(1.074)+(5.004), (I-655)+(1.074)+(5.005), (I-655)+(1.074)+(5.006), (I-655)+(1.074)+(5.007), (I-655)+(1.074)+(5.008), (I-655)+(1.074)+(5.009), (I-655)+(1.074)+(5.010), (I-655)+(1.074)+(5.011), (I-655)+(1.074)+(5.012), (I-655)+(1.074)+(5.013), (I-655)+(1.074)+(5.014), (I-655)+(1.074)+(5.015), (I-655)+(1.074)+(5.016), (I-655)+(1.074)+(5.017), (I-655)+(1.074)+(5.018), (I-655)+(1.074)+(5.019), (I-655)+(1.074)+(5.020), (I-655)+(1.074)+(5.021), (I-655)+(1.074)+(5.022), (I-655)+(1.074)+(5.023), (I-655)+(1.074)+(6.001), (I-655)+(1.074)+(6.002), (I-655)+(1.074)+(6.003), (I-655)+(1.074)+(6.004), (I-655)+(1.074)+(7.001), (I-655)+(1.074)+(7.002), (I-655)+(1.074)+(7.003), (I-655)+(1.074)+(7.004), (I-655)+(1.074)+(7.005), (I-655)+(1.074)+(7.006), (I-655)+(1.074)+(9.001), (I-655)+(1.074)+(9.002), (I-655)+(1.074)+(9.003), (I-655)+(1.074)+(9.004), (I-655)+(1.074)+(9.005), (I-655)+(1.074)+(9.006), (I-655)+(1.074)+(9.007), (I-655)+(1.074)+(9.008), (I-655)+(1.074)+(9.009), (I-655)+(1.074)+(14.001), (I-655)+(1.074)+(14.002), (I-655)+(1.074)+(15.008), (I-655)+(1.074)+(15.011), (I-655)+(1.074)+(15.012), (I-655)+(1.074)+(15.016), (I-655)+(1.074)+(15.025), (I-655)+(1.074)+(15.027), (I-655)+(1.074)+(15.047), (I-655)+(1.074)+(15.063), (I-655)+(1.074)+(15.064), (I-655)+(1.074)+(16.001), (I-655)+(1.074)+(16.002), (I-655)+(1.074)+(16.003), (I-655)+(1.074)+(16.004), (I-655)+(1.074)+(16.005), (I-655)+(1.074)+(16.006), (I-655)+(1.074)+(16.007), (I-655)+(1.074)+(16.008), (I-655)+(1.074)+(17.001), (I-655)+(1.074)+(17.002), (I-655)+(1.074)+(17.003), (I-655)+(1.074)+(17.004), (I-655)+(1.074)+(17.005), (I-655)+(1.074)+(17.006), (I-655)+(1.074)+(17.007), (I-655)+(1.074)+(17.008), (I-655)+(1.074)+(17.009), (I-655)+(1.074)+(17.010), (I-655)+(1.074)+(17.011), (I-655)+(1.074)+(17.012), (I-655)+(1.074)+(18.001),

(I-655)+(1.075)+(1.076), (I-655)+(1.075)+(1.077), (I-655)+(1.075)+(1.078), (I-655)+(1.075)+(1.079), (I-655)+(1.075)+(1.080), (I-655)+(1.075)+(1.081), (I-655)+(1.075)+(1.082), (I-655)+(1.075)+(1.083), (I-655)+(1.075)+(1.084), (I-655)+(1.075)+(1.085), (I-655)+(1.075)+(1.086), (I-655)+(1.075)+(1.087), (I-655)+(1.075)+(1.088), (I-655)+(1.075)+(1.089), (I-655)+(1.075)+(1.090), (I-655)+(1.075)+(1.091), (I-655)+(1.075)+(1.092), (I-655)+(1.075)+(2.001), (I-655)+(1.075)+(2.002), (I-655)+(1.075)+(2.003), (I-655)+(1.075)+(2.004), (I-655)+(1.075)+(2.005), (I-655)+(1.075)+(2.006), (I-655)+(1.075)+(2.007), (I-655)+(1.075)+(2.008), (I-655)+(1.075)+(2.009), (I-655)+(1.075)+(2.010), (I-655)+(1.075)+(2.011), (I-655)+(1.075)+(2.012), (I-655)+(1.075)+(2.013), (I-655)+(1.075)+(2.014), (I-655)+(1.075)+(2.015), (I-655)+(1.075)+(2.016), (I-655)+(1.075)+(2.017), (I-655)+(1.075)+(2.018), (I-655)+(1.075)+(2.019), (I-655)+(1.075)+(2.020), (I-655)+(1.075)+(2.021), (I-655)+(1.075)+(2.022), (I-655)+(1.075)+(2.023), (I-655)+(1.075)+(2.024), (I-655)+(1.075)+(2.025), (I-655)+(1.075)+(2.026), (I-655)+(1.075)+(2.027), (I-655)+(1.075)+(2.028), (I-655)+(1.075)+(2.029), (I-655)+(1.075)+(2.030), (I-655)+(1.075)+(2.031), (I-655)+(1.075)+(2.032), (I-655)+(1.075)+(2.033), (I-655)+(1.075)+(2.034), (I-655)+(1.075)+(2.035), (I-655)+(1.075)+(2.036), (I-655)+(1.075)+(2.037), (I-655)+(1.075)+(2.038), (I-655)+(1.075)+(2.039), (I-655)+(1.075)+(2.040), (I-655)+(1.075)+(2.041), (I-655)+(1.075)+(2.042), (I-655)+(1.075)+(2.043), (I-655)+(1.075)+(2.044), (I-655)+(1.075)+(2.045), (I-655)+(1.075)+(2.046), (I-655)+(1.075)+(2.047), (I-655)+(1.075)+(2.048), (I-655)+(1.075)+(2.049), (I-655)+(1.075)+(2.050), (I-655)+(1.075)+(2.051), (I-655)+(1.075)+(2.052), (I-655)+(1.075)+(2.053), (I-655)+(1.075)+(2.054), (I-655)+(1.075)+(2.055), (I-655)+(1.075)+(2.056), (I-655)+(1.075)+(2.057), (I-655)+(1.075)+(2.058), (I-655)+(1.075)+(2.059), (I-655)+(1.075)+(3.001), (I-655)+(1.075)+(3.002), (I-655)+(1.075)+(3.003), (I-655)+(1.075)+(3.004), (I-655)+(1.075)+(3.005), (I-655)+(1.075)+(3.006), (I-655)+(1.075)+(3.007), (I-655)+(1.075)+(3.008), (I-655)+(1.075)+(3.009), (I-655)+(1.075)+(3.010), (I-655)+(1.075)+(3.011), (I-655)+(1.075)+(3.012), (I-655)+(1.075)+(3.013), (I-655)+(1.075)+(3.014), (I-655)+(1.075)+(3.015), (I-655)+(1.075)+(3.016), (I-655)+(1.075)+(3.017), (I-655)+(1.075)+(3.018), (I-655)+(1.075)+(3.019), (I-655)+(1.075)+(3.020), (I-655)+(1.075)+(3.021), (I-655)+(1.075)+(3.022), (I-655)+(1.075)+(3.023), (I-655)+(1.075)+(3.024), (I-655)+(1.075)+(3.025), (I-655)+(1.075)+(3.026), (I-655)+(1.075)+(3.027), (I-655)+(1.075)+(3.028), (I-655)+(1.075)+(3.029), (I-655)+(1.075)+(3.030), (I-655)+(1.075)+(3.031), (I-655)+(1.075)+(5.001), (I-655)+(1.075)+(5.002), (I-655)+(1.075)+(5.003), (I-655)+(1.075)+(5.004), (I-655)+(1.075)+(5.005), (I-655)+(1.075)+(5.006), (I-655)+(1.075)+(5.007), (I-655)+(1.075)+(5.008), (I-655)+(1.075)+(5.009), (I-655)+(1.075)+(5.010), (I-655)+(1.075)+(5.011), (I-655)+(1.075)+(5.012), (I-655)+(1.075)+(5.013), (I-655)+(1.075)+(5.014), (I-655)+(1.075)+(5.015), (I-655)+(1.075)+(5.016), (I-655)+(1.075)+(5.017), (I-655)+(1.075)+(5.018), (I-655)+(1.075)+(5.019), (I-655)+(1.075)+(5.020), (I-655)+(1.075)+(5.021), (I-655)+(1.075)+(5.022), (I-655)+(1.075)+(5.023), (I-655)+(1.075)+(6.001), (I-655)+(1.075)+(6.002), (I-655)+(1.075)+(6.003), (I-655)+(1.075)+(6.004), (I-655)+(1.075)+(7.001), (I-655)+(1.075)+(7.002), (I-655)+(1.075)+(7.003), (I-655)+(1.075)+(7.004), (I-655)+(1.075)+(7.005), (I-655)+(1.075)+(7.006), (I-655)+(1.075)+(9.001), (I-655)+(1.075)+(9.002), (I-655)+(1.075)+(9.003), (I-655)+(1.075)+(9.004), (I-655)+(1.075)+(9.005), (I-655)+(1.075)+(9.006), (I-655)+(1.075)+(9.007), (I-655)+(1.075)+(9.008), (I-655)+(1.075)+(9.009), (I-655)+(1.075)+(14.001), (I-655)+(1.075)+(14.002), (I-655)+(1.075)+(15.008), (I-655)+(1.075)+(15.011), (I-655)+(1.075)+(15.012), (I-655)+(1.075)+(15.016), (I-655)+(1.075)+(15.025), (I-655)+(1.075)+(15.027), (I-655)+(1.075)+(15.047), (I-655)+(1.075)+(15.063), (I-655)+(1.075)+(15.064), (I-655)+(1.075)+(16.001), (I-655)+(1.075)+(16.002), (I-655)+(1.075)+(16.003), (I-655)+(1.075)+(16.004), (I-655)+(1.075)+(16.005), (I-655)+(1.075)+(16.006), (I-655)+(1.075)+(16.007), (I-655)+(1.075)+(16.008), (I-655)+(1.075)+(17.001), (I-655)+(1.075)+(17.002), (I-655)+(1.075)+(17.003), (I-655)+(1.075)+(17.004), (I-655)+(1.075)+(17.005), (I-655)+(1.075)+(17.006), (I-655)+(1.075)+(17.007), (I-655)+(1.075)+(17.008), (I-655)+(1.075)+(17.009), (I-655)+(1.075)+(17.010), (I-655)+(1.075)+(17.011), (I-655)+(1.075)+(17.012), (I-655)+(1.075)+(18.001),

(I-655)+(1.076)+(1.077), (I-655)+(1.076)+(1.078), (I-655)+(1.076)+(1.079), (I-655)+(1.076)+(1.080), (I-655)+(1.076)+(1.081), (I-655)+(1.076)+(1.082), (I-655)+(1.076)+(1.083), (I-655)+(1.076)+(1.084), (I-655)+(1.076)+(1.085), (I-655)+(1.076)+(1.086), (I-655)+(1.076)+(1.087), (I-655)+(1.076)+(1.088), (I-655)+(1.076)+(1.089), (I-655)+(1.076)+(1.090), (I-655)+(1.076)+(1.091), (I-655)+(1.076)+(1.092), (I-655)+(1.076)+(2.001), (I-655)+(1.076)+(2.002), (I-655)+(1.076)+(2.003), (I-655)+(1.076)+(2.004), (I-655)+(1.076)+(2.005), (I-655)+(1.076)+(2.006), (I-655)+(1.076)+(2.007), (I-655)+(1.076)+(2.008), (I-655)+(1.076)+(2.009), (I-655)+(1.076)+(2.010), (I-655)+(1.076)+(2.011), (I-655)+(1.076)+(2.012), (I-655)+(1.076)+(2.013), (I-655)+(1.076)+(2.014), (I-655)+(1.076)+(2.015), (I-655)+(1.076)+(2.016), (I-655)+(1.076)+(2.017), (I-655)+(1.076)+(2.018), (I-655)+(1.076)+(2.019), (I-655)+(1.076)+(2.020), (I-655)+(1.076)+(2.021), (I-655)+(1.076)+(2.022), (I-655)+(1.076)+(2.023), (I-655)+(1.076)+(2.024), (I-655)+(1.076)+(2.025), (I-655)+(1.076)+(2.026), (I-655)+(1.076)+(2.027), (I-655)+(1.076)+(2.028), (I-655)+(1.076)+(2.029), (I-655)+(1.076)+(2.030), (I-655)+(1.076)+(2.031), (I-655)+(1.076)+(2.032), (I-655)+(1.076)+(2.033), (I-655)+(1.076)+(2.034), (I-655)+(1.076)+(2.035), (I-655)+(1.076)+(2.036), (I-655)+(1.076)+(2.037), (I-655)+(1.076)+(2.038), (I-655)+(1.076)+(2.039), (I-655)+(1.076)+(2.040), (I-655)+(1.076)+(2.041), (I-655)+(1.076)+(2.042), (I-655)+(1.076)+(2.043), (I-655)+(1.076)+(2.044), (I-655)+(1.076)+(2.045), (I-655)+(1.076)+(2.046), (I-655)+(1.076)+(2.047), (I-655)+(1.076)+(2.048), (I-655)+(1.076)+(2.049), (I-655)+(1.076)+(2.050), (I-655)+(1.076)+(2.051), (I-655)+(1.076)+(2.052), (I-655)+(1.076)+(2.053), (I-655)+(1.076)+(2.054), (I-655)+(1.076)+(2.055), (I-655)+(1.076)+(2.056), (I-655)+(1.076)+(2.057), (I-655)+(1.076)+(2.058), (I-655)+(1.076)+(2.059), (I-655)+(1.076)+(3.001), (I-655)+(1.076)+(3.002), (I-655)+(1.076)+(3.003), (I-655)+(1.076)+(3.004), (I-655)+(1.076)+(3.005), (I-655)+(1.076)+(3.006), (I-655)+(1.076)+(3.007), (I-655)+(1.076)+(3.008), (I-655)+(1.076)+(3.009), (I-655)+(1.076)+(3.010), (I-655)+(1.076)+(3.011), (I-655)+(1.076)+(3.012), (I-655)+(1.076)+(3.013), (I-655)+(1.076)+(3.014), (I-655)+(1.076)+(3.015), (I-655)+(1.076)+(3.016), (I-655)+(1.076)+(3.017), (I-655)+(1.076)+(3.018), (I-655)+(1.076)+(3.019), (I-655)+(1.076)+(3.020), (I-655)+(1.076)+(3.021), (I-655)+(1.076)+(3.022), (I-655)+(1.076)+(3.023), (I-655)+(1.076)+(3.024), (I-655)+(1.076)+(3.025), (I-655)+(1.076)+(3.026), (I-655)+(1.076)+(3.027), (I-655)+(1.076)+(3.028), (I-655)+(1.076)+(3.029), (I-655)+(1.076)+(3.030), (I-655)+(1.076)+(3.031), (I-655)+(1.076)+(5.001), (I-655)+(1.076)+(5.002), (I-655)+(1.076)+(5.003), (I-655)+(1.076)+(5.004), (I-655)+(1.076)+(5.005), (I-655)+(1.076)+(5.006), (I-655)+(1.076)+(5.007), (I-655)+(1.076)+(5.008), (I-655)+(1.076)+(5.009), (I-655)+(1.076)+(5.010), (I-655)+(1.076)+(5.011), (I-655)+(1.076)+(5.012), (I-655)+(1.076)+(5.013), (I-655)+(1.076)+(5.014), (I-655)+(1.076)+(5.015), (I-655)+(1.076)+(5.016), (I-655)+(1.076)+(5.017), (I-655)+(1.076)+(5.018), (I-655)+(1.076)+(5.019), (I-655)+(1.076)+(5.020), (I-655)+(1.076)+(5.021), (I-655)+(1.076)+(5.022), (I-655)+(1.076)+(5.023), (I-655)+(1.076)+(6.001), (I-655)+(1.076)+(6.002), (I-655)+(1.076)+(6.003), (I-655)+(1.076)+(6.004), (I-655)+(1.076)+(7.001), (I-655)+(1.076)+(7.002), (I-655)+(1.076)+(7.003), (I-655)+(1.076)+(7.004), (I-655)+(1.076)+(7.005), (I-655)+(1.076)+(7.006), (I-655)+(1.076)+(9.001), (I-655)+(1.076)+(9.002), (I-655)+(1.076)+(9.003), (I-655)+(1.076)+(9.004), (I-655)+(1.076)+(9.005), (I-655)+(1.076)+(9.006), (I-655)+(1.076)+(9.007), (I-655)+(1.076)+(9.008), (I-655)+(1.076)+(9.009), (I-655)+(1.076)+(14.001), (I-655)+(1.076)+(14.002), (I-655)+(1.076)+(15.008), (I-655)+(1.076)+(15.011), (I-655)+(1.076)+(15.012), (I-655)+(1.076)+(15.016), (I-655)+(1.076)+(15.025), (I-655)+(1.076)+(15.027), (I-655)+(1.076)+(15.047), (I-655)+(1.076)+(15.063), (I-655)+(1.076)+(15.064), (I-655)+(1.076)+(16.001), (I-655)+(1.076)+(16.002), (I-655)+(1.076)+(16.003), (I-655)+(1.076)+(16.004), (I-655)+(1.076)+(16.005), (I-655)+(1.076)+(16.006), (I-655)+(1.076)+(16.007), (I-655)+(1.076)+(16.008), (I-655)+(1.076)+(17.001), (I-655)+(1.076)+(17.002), (I-655)+(1.076)+(17.003), (I-655)+(1.076)+(17.004), (I-655)+(1.076)+(17.005), (I-655)+(1.076)+(17.006), (I-655)+(1.076)+(17.007), (I-655)+(1.076)+(17.008), (I-655)+(1.076)+(17.009), (I-655)+(1.076)+(17.010), (I-655)+(1.076)+(17.011), (I-655)+(1.076)+(17.012), (I-655)+(1.076)+(18.001),

(I-655)+(1.077)+(1.078), (I-655)+(1.077)+(1.079), (I-655)+(1.077)+(1.080), (I-655)+(1.077)+(1.081), (I-655)+(1.077)+(1.082), (I-655)+(1.077)+(1.083), (I-655)+(1.077)+(1.084), (I-655)+(1.077)+(1.085), (I-655)+(1.077)+(1.086), (I-655)+(1.077)+(1.087), (I-655)+(1.077)+(1.088), (I-655)+(1.077)+(1.089), (I-655)+(1.077)+(1.090), (I-655)+(1.077)+(1.091), (I-655)+(1.077)+(1.092), (I-655)+(1.077)+(2.001), (I-655)+(1.077)+(2.002), (I-655)+(1.077)+(2.003), (I-655)+(1.077)+(2.004), (I-655)+(1.077)+(2.005), (I-655)+(1.077)+(2.006), (I-655)+(1.077)+(2.007), (I-655)+(1.077)+(2.008), (I-655)+(1.077)+(2.009), (I-655)+(1.077)+(2.010), (I-655)+(1.077)+(2.011), (I-655)+(1.077)+(2.012), (I-655)+(1.077)+(2.013), (I-655)+(1.077)+(2.014), (I-655)+(1.077)+(2.015), (I-655)+(1.077)+(2.016), (I-655)+(1.077)+(2.017), (I-655)+(1.077)+(2.018), (I-655)+(1.077)+(2.019), (I-655)+(1.077)+(2.020), (I-655)+(1.077)+(2.021), (I-655)+(1.077)+(2.022), (I-655)+(1.077)+(2.023), (I-655)+(1.077)+(2.024), (I-655)+(1.077)+(2.025), (I-655)+(1.077)+(2.026), (I-655)+(1.077)+(2.027), (I-655)+(1.077)+(2.028), (I-655)+(1.077)+(2.029), (I-655)+(1.077)+(2.030), (I-655)+(1.077)+(2.031), (I-655)+(1.077)+(2.032), (I-655)+(1.077)+(2.033), (I-655)+(1.077)+(2.034), (I-655)+(1.077)+(2.035), (I-655)+(1.077)+(2.036), (I-655)+(1.077)+(2.037), (I-655)+(1.077)+(2.038), (I-655)+(1.077)+(2.039), (I-655)+(1.077)+(2.040), (I-655)+(1.077)+(2.041), (I-655)+(1.077)+(2.042), (I-655)+(1.077)+(2.043), (I-655)+(1.077)+(2.044), (I-655)+(1.077)+(2.045), (I-655)+(1.077)+(2.046), (I-655)+(1.077)+(2.047), (I-655)+(1.077)+(2.048), (I-655)+(1.077)+(2.049), (I-655)+(1.077)+(2.050), (I-655)+(1.077)+(2.051), (I-655)+(1.077)+(2.052), (I-655)+(1.077)+(2.053), (I-655)+(1.077)+(2.054), (I-655)+(1.077)+(2.055), (I-655)+(1.077)+(2.056), (I-655)+(1.077)+(2.057), (I-655)+(1.077)+(2.058), (I-655)+(1.077)+(2.059), (I-655)+(1.077)+(3.001), (I-655)+(1.077)+(3.002), (I-655)+(1.077)+(3.003), (I-655)+(1.077)+(3.004), (I-655)+(1.077)+(3.005), (I-655)+(1.077)+(3.006), (I-655)+(1.077)+(3.007), (I-655)+(1.077)+(3.008), (I-655)+(1.077)+(3.009), (I-655)+(1.077)+(3.010), (I-655)+(1.077)+(3.011), (I-655)+(1.077)+(3.012), (I-655)+(1.077)+(3.013), (I-655)+(1.077)+(3.014), (I-655)+(1.077)+(3.015), (I-655)+(1.077)+(3.016), (I-655)+(1.077)+(3.017), (I-655)+(1.077)+(3.018), (I-655)+(1.077)+(3.019), (I-655)+(1.077)+(3.020), (I-655)+(1.077)+(3.021), (I-655)+(1.077)+(3.022), (I-655)+(1.077)+(3.023), (I-655)+(1.077)+(3.024), (I-655)+(1.077)+(3.025), (I-655)+(1.077)+(3.026), (I-655)+(1.077)+(3.027), (I-655)+(1.077)+(3.028), (I-655)+(1.077)+(3.029), (I-655)+(1.077)+(3.030), (I-655)+(1.077)+(3.031), (I-655)+(1.077)+(5.001), (I-655)+(1.077)+(5.002), (I-655)+(1.077)+(5.003), (I-655)+(1.077)+(5.004), (I-655)+(1.077)+(5.005), (I-655)+(1.077)+(5.006), (I-655)+(1.077)+(5.007), (I-655)+(1.077)+(5.008), (I-655)+(1.077)+(5.009), (I-655)+(1.077)+(5.010), (I-655)+(1.077)+(5.011), (I-655)+(1.077)+(5.012), (I-655)+(1.077)+(5.013), (I-655)+(1.077)+(5.014), (I-655)+(1.077)+(5.015), (I-655)+(1.077)+(5.016), (I-655)+(1.077)+(5.017), (I-655)+(1.077)+(5.018), (I-655)+(1.077)+(5.019), (I-655)+(1.077)+(5.020), (I-655)+(1.077)+(5.021), (I-655)+(1.077)+(5.022), (I-655)+(1.077)+(5.023), (I-655)+(1.077)+(6.001), (I-655)+(1.077)+(6.002), (I-655)+(1.077)+(6.003), (I-655)+(1.077)+(6.004), (I-655)+(1.077)+(7.001), (I-655)+(1.077)+(7.002), (I-655)+(1.077)+(7.003), (I-655)+(1.077)+(7.004), (I-655)+(1.077)+(7.005), (I-655)+(1.077)+(7.006), (I-655)+(1.077)+(9.001), (I-655)+(1.077)+(9.002), (I-655)+(1.077)+(9.003), (I-655)+(1.077)+(9.004), (I-655)+(1.077)+(9.005), (I-655)+(1.077)+(9.006), (I-655)+(1.077)+(9.007), (I-655)+(1.077)+(9.008), (I-655)+(1.077)+(9.009), (I-655)+(1.077)+(14.001), (I-655)+(1.077)+(14.002), (I-655)+(1.077)+(15.008), (I-655)+(1.077)+(15.011), (I-655)+(1.077)+(15.012), (I-655)+(1.077)+(15.016), (I-655)+(1.077)+(15.025), (I-655)+(1.077)+(15.027), (I-655)+(1.077)+(15.047), (I-655)+(1.077)+(15.063), (I-655)+(1.077)+(15.064), (I-655)+(1.077)+(16.001), (I-655)+(1.077)+(16.002), (I-655)+(1.077)+(16.003), (I-655)+(1.077)+(16.004), (I-655)+(1.077)+(16.005), (I-655)+(1.077)+(16.006), (I-655)+(1.077)+(16.007), (I-655)+(1.077)+(16.008), (I-655)+(1.077)+(17.001), (I-655)+(1.077)+(17.002), (I-655)+(1.077)+(17.003), (I-655)+(1.077)+(17.004), (I-655)+(1.077)+(17.005), (I-655)+(1.077)+(17.006), (I-655)+(1.077)+(17.007), (I-655)+(1.077)+(17.008), (I-655)+(1.077)+(17.009), (I-655)+(1.077)+(17.010), (I-655)+(1.077)+(17.011), (I-655)+(1.077)+(17.012), (I-655)+(1.077)+(18.001),

(I-655)+(1.078)+(1.079), (I-655)+(1.078)+(1.080), (I-655)+(1.078)+(1.081), (I-655)+(1.078)+(1.082), (I-655)+(1.078)+(1.083), (I-655)+(1.078)+(1.084), (I-655)+(1.078)+(1.085), (I-655)+(1.078)+(1.086), (I-655)+(1.078)+(1.087), (I-655)+(1.078)+(1.088), (I-655)+(1.078)+(1.089), (I-655)+(1.078)+(1.090), (I-655)+(1.078)+(1.091), (I-655)+(1.078)+(1.092), (I-655)+(1.078)+(2.001), (I-655)+(1.078)+(2.002), (I-655)+(1.078)+(2.003), (I-655)+(1.078)+(2.004), (I-655)+(1.078)+(2.005), (I-655)+(1.078)+(2.006), (I-655)+(1.078)+(2.007), (I-655)+(1.078)+(2.008), (I-655)+(1.078)+(2.009), (I-655)+(1.078)+(2.010), (I-655)+(1.078)+(2.011), (I-655)+(1.078)+(2.012), (I-655)+(1.078)+(2.013), (I-655)+(1.078)+(2.014), (I-655)+(1.078)+(2.015), (I-655)+(1.078)+(2.016), (I-655)+(1.078)+(2.017), (I-655)+(1.078)+(2.018), (I-655)+(1.078)+(2.019), (I-655)+(1.078)+(2.020), (I-655)+(1.078)+(2.021), (I-655)+(1.078)+(2.022), (I-655)+(1.078)+(2.023), (I-655)+(1.078)+(2.024), (I-655)+(1.078)+(2.025), (I-655)+(1.078)+(2.026), (I-655)+(1.078)+(2.027), (I-655)+(1.078)+(2.028), (I-655)+(1.078)+(2.029), (I-655)+(1.078)+(2.030), (I-655)+(1.078)+(2.031), (I-655)+(1.078)+(2.032), (I-655)+(1.078)+(2.033), (I-655)+(1.078)+(2.034), (I-655)+(1.078)+(2.035), (I-655)+(1.078)+(2.036), (I-655)+(1.078)+(2.037), (I-655)+(1.078)+(2.038), (I-655)+(1.078)+(2.039), (I-655)+(1.078)+(2.040), (I-655)+(1.078)+(2.041), (I-655)+(1.078)+(2.042), (I-655)+(1.078)+(2.043), (I-655)+(1.078)+(2.044), (I-655)+(1.078)+(2.045), (I-655)+(1.078)+(2.046), (I-655)+(1.078)+(2.047), (I-655)+(1.078)+(2.048), (I-655)+(1.078)+(2.049), (I-655)+(1.078)+(2.050), (I-655)+(1.078)+(2.051), (I-655)+(1.078)+(2.052), (I-655)+(1.078)+(2.053), (I-655)+(1.078)+(2.054), (I-655)+(1.078)+(2.055), (I-655)+(1.078)+(2.056), (I-655)+(1.078)+(2.057), (I-655)+(1.078)+(2.058), (I-655)+(1.078)+(2.059), (I-655)+(1.078)+(3.001), (I-655)+(1.078)+(3.002), (I-655)+(1.078)+(3.003), (I-655)+(1.078)+(3.004), (I-655)+(1.078)+(3.005), (I-655)+(1.078)+(3.006), (I-655)+(1.078)+(3.007), (I-655)+(1.078)+(3.008), (I-655)+(1.078)+(3.009), (I-655)+(1.078)+(3.010), (I-655)+(1.078)+(3.011), (I-655)+(1.078)+(3.012), (I-655)+(1.078)+(3.013), (I-655)+(1.078)+(3.014), (I-655)+(1.078)+(3.015), (I-655)+(1.078)+(3.016), (I-655)+(1.078)+(3.017), (I-655)+(1.078)+(3.018), (I-655)+(1.078)+(3.019), (I-655)+(1.078)+(3.020), (I-655)+(1.078)+(3.021), (I-655)+(1.078)+(3.022), (I-655)+(1.078)+(3.023), (I-655)+(1.078)+(3.024), (I-655)+(1.078)+(3.025), (I-655)+(1.078)+(3.026), (I-655)+(1.078)+(3.027), (I-655)+(1.078)+(3.028), (I-655)+(1.078)+(3.029), (I-655)+(1.078)+(3.030), (I-655)+(1.078)+(3.031), (I-655)+(1.078)+(5.001), (I-655)+(1.078)+(5.002), (I-655)+(1.078)+(5.003), (I-655)+(1.078)+(5.004), (I-655)+(1.078)+(5.005), (I-655)+(1.078)+(5.006), (I-655)+(1.078)+(5.007), (I-655)+(1.078)+(5.008), (I-655)+(1.078)+(5.009), (I-655)+(1.078)+(5.010), (I-655)+(1.078)+(5.011), (I-655)+(1.078)+(5.012), (I-655)+(1.078)+(5.013), (I-655)+(1.078)+(5.014), (I-655)+(1.078)+(5.015), (I-655)+(1.078)+(5.016), (I-655)+(1.078)+(5.017), (I-655)+(1.078)+(5.018), (I-655)+(1.078)+(5.019), (I-655)+(1.078)+(5.020), (I-655)+(1.078)+(5.021), (I-655)+(1.078)+(5.022), (I-655)+(1.078)+(5.023), (I-655)+(1.078)+(6.001), (I-655)+(1.078)+(6.002), (I-655)+(1.078)+(6.003), (I-655)+(1.078)+(6.004), (I-655)+(1.078)+(7.001), (I-655)+(1.078)+(7.002), (I-655)+(1.078)+(7.003), (I-655)+(1.078)+(7.004), (I-655)+(1.078)+(7.005), (I-655)+(1.078)+(7.006), (I-655)+(1.078)+(9.001), (I-655)+(1.078)+(9.002), (I-655)+(1.078)+(9.003), (I-655)+(1.078)+(9.004), (I-655)+(1.078)+(9.005), (I-655)+(1.078)+(9.006), (I-655)+(1.078)+(9.007), (I-655)+(1.078)+(9.008), (I-655)+(1.078)+(9.009), (I-655)+(1.078)+(14.001), (I-655)+(1.078)+(14.002), (I-655)+(1.078)+(15.008), (I-655)+(1.078)+(15.011), (I-655)+(1.078)+(15.012), (I-655)+(1.078)+(15.016), (I-655)+(1.078)+(15.025), (I-655)+(1.078)+(15.027), (I-655)+(1.078)+(15.047), (I-655)+(1.078)+(15.063), (I-655)+(1.078)+(15.064), (I-655)+(1.078)+(16.001), (I-655)+(1.078)+(16.002), (I-655)+(1.078)+(16.003), (I-655)+(1.078)+(16.004), (I-655)+(1.078)+(16.005), (I-655)+(1.078)+(16.006), (I-655)+(1.078)+(16.007), (I-655)+(1.078)+(16.008), (I-655)+(1.078)+(17.001), (I-655)+(1.078)+(17.002), (I-655)+(1.078)+(17.003), (I-655)+(1.078)+(17.004), (I-655)+(1.078)+(17.005), (I-655)+(1.078)+(17.006), (I-655)+(1.078)+(17.007), (I-655)+(1.078)+(17.008), (I-655)+(1.078)+(17.009), (I-655)+(1.078)+(17.010), (I-655)+(1.078)+(17.011), (I-655)+(1.078)+(17.012), (I-655)+(1.078)+(18.001),

(I-655)+(1.079)+(1.080), (I-655)+(1.079)+(1.081), (I-655)+(1.079)+(1.082), (I-655)+(1.079)+(1.083), (I-655)+(1.079)+(1.084), (I-655)+(1.079)+(1.085), (I-655)+(1.079)+(1.086), (I-655)+(1.079)+(1.087), (I-655)+(1.079)+(1.088), (I-655)+(1.079)+(1.089), (I-655)+(1.079)+(1.090), (I-655)+(1.079)+(1.091), (I-655)+(1.079)+(1.092), (I-655)+(1.079)+(2.001), (I-655)+(1.079)+(2.002), (I-655)+(1.079)+(2.003), (I-655)+(1.079)+(2.004), (I-655)+(1.079)+(2.005), (I-655)+(1.079)+(2.006), (I-655)+(1.079)+(2.007), (I-655)+(1.079)+(2.008), (I-655)+(1.079)+(2.009), (I-655)+(1.079)+(2.010), (I-655)+(1.079)+(2.011), (I-655)+(1.079)+(2.012), (I-655)+(1.079)+(2.013), (I-655)+(1.079)+(2.014), (I-655)+(1.079)+(2.015), (I-655)+(1.079)+(2.016), (I-655)+(1.079)+(2.017), (I-655)+(1.079)+(2.018), (I-655)+(1.079)+(2.019), (I-655)+(1.079)+(2.020), (I-655)+(1.079)+(2.021), (I-655)+(1.079)+(2.022), (I-655)+(1.079)+(2.023), (I-655)+(1.079)+(2.024), (I-655)+(1.079)+(2.025), (I-655)+(1.079)+(2.026), (I-655)+(1.079)+(2.027), (I-655)+(1.079)+(2.028), (I-655)+(1.079)+(2.029), (I-655)+(1.079)+(2.030), (I-655)+(1.079)+(2.031), (I-655)+(1.079)+(2.032), (I-655)+(1.079)+(2.033), (I-655)+(1.079)+(2.034), (I-655)+(1.079)+(2.035), (I-655)+(1.079)+(2.036), (I-655)+(1.079)+(2.037), (I-655)+(1.079)+(2.038), (I-655)+(1.079)+(2.039), (I-655)+(1.079)+(2.040), (I-655)+(1.079)+(2.041), (I-655)+(1.079)+(2.042), (I-655)+(1.079)+(2.043), (I-655)+(1.079)+(2.044), (I-655)+(1.079)+(2.045), (I-655)+(1.079)+(2.046), (I-655)+(1.079)+(2.047), (I-655)+(1.079)+(2.048), (I-655)+(1.079)+(2.049), (I-655)+(1.079)+(2.050), (I-655)+(1.079)+(2.051), (I-655)+(1.079)+(2.052), (I-655)+(1.079)+(2.053), (I-655)+(1.079)+(2.054), (I-655)+(1.079)+(2.055), (I-655)+(1.079)+(2.056), (I-655)+(1.079)+(2.057), (I-655)+(1.079)+(2.058), (I-655)+(1.079)+(2.059), (I-655)+(1.079)+(3.001), (I-655)+(1.079)+(3.002), (I-655)+(1.079)+(3.003), (I-655)+(1.079)+(3.004), (I-655)+(1.079)+(3.005), (I-655)+(1.079)+(3.006), (I-655)+(1.079)+(3.007), (I-655)+(1.079)+(3.008), (I-655)+(1.079)+(3.009), (I-655)+(1.079)+(3.010), (I-655)+(1.079)+(3.011), (I-655)+(1.079)+(3.012), (I-655)+(1.079)+(3.013), (I-655)+(1.079)+(3.014), (I-655)+(1.079)+(3.015), (I-655)+(1.079)+(3.016), (I-655)+(1.079)+(3.017), (I-655)+(1.079)+(3.018), (I-655)+(1.079)+(3.019), (I-655)+(1.079)+(3.020), (I-655)+(1.079)+(3.021), (I-655)+(1.079)+(3.022), (I-655)+(1.079)+(3.023), (I-655)+(1.079)+(3.024), (I-655)+(1.079)+(3.025), (I-655)+(1.079)+(3.026), (I-655)+(1.079)+(3.027), (I-655)+(1.079)+(3.028), (I-655)+(1.079)+(3.029), (I-655)+(1.079)+(3.030), (I-655)+(1.079)+(3.031), (I-655)+(1.079)+(5.001), (I-655)+(1.079)+(5.002), (I-655)+(1.079)+(5.003), (I-655)+(1.079)+(5.004), (I-655)+(1.079)+(5.005), (I-655)+(1.079)+(5.006), (I-655)+(1.079)+(5.007), (I-655)+(1.079)+(5.008), (I-655)+(1.079)+(5.009), (I-655)+(1.079)+(5.010), (I-655)+(1.079)+(5.011), (I-655)+(1.079)+(5.012), (I-655)+(1.079)+(5.013), (I-655)+(1.079)+(5.014), (I-655)+(1.079)+(5.015), (I-655)+(1.079)+(5.016), (I-655)+(1.079)+(5.017), (I-655)+(1.079)+(5.018), (I-655)+(1.079)+(5.019), (I-655)+(1.079)+(5.020), (I-655)+(1.079)+(5.021), (I-655)+(1.079)+(5.022), (I-655)+(1.079)+(5.023), (I-655)+(1.079)+(6.001), (I-655)+(1.079)+(6.002), (I-655)+(1.079)+(6.003), (I-655)+(1.079)+(6.004), (I-655)+(1.079)+(7.001), (I-655)+(1.079)+(7.002), (I-655)+(1.079)+(7.003), (I-655)+(1.079)+(7.004), (I-655)+(1.079)+(7.005), (I-655)+(1.079)+(7.006), (I-655)+(1.079)+(9.001), (I-655)+(1.079)+(9.002), (I-655)+(1.079)+(9.003), (I-655)+(1.079)+(9.004), (I-655)+(1.079)+(9.005), (I-655)+(1.079)+(9.006), (I-655)+(1.079)+(9.007), (I-655)+(1.079)+(9.008), (I-655)+(1.079)+(9.009), (I-655)+(1.079)+(14.001), (I-655)+(1.079)+(14.002), (I-655)+(1.079)+(15.008), (I-655)+(1.079)+(15.011), (I-655)+(1.079)+(15.012), (I-655)+(1.079)+(15.016), (I-655)+(1.079)+(15.025), (I-655)+(1.079)+(15.027), (I-655)+(1.079)+(15.047), (I-655)+(1.079)+(15.063), (I-655)+(1.079)+(15.064), (I-655)+(1.079)+(16.001), (I-655)+(1.079)+(16.002), (I-655)+(1.079)+(16.003), (I-655)+(1.079)+(16.004), (I-655)+(1.079)+(16.005), (I-655)+(1.079)+(16.006), (I-655)+(1.079)+(16.007), (I-655)+(1.079)+(16.008), (I-655)+(1.079)+(17.001), (I-655)+(1.079)+(17.002), (I-655)+(1.079)+(17.003), (I-655)+(1.079)+(17.004), (I-655)+(1.079)+(17.005), (I-655)+(1.079)+(17.006), (I-655)+(1.079)+(17.007), (I-655)+(1.079)+(17.008), (I-655)+(1.079)+(17.009), (I-655)+(1.079)+(17.010), (I-655)+(1.079)+(17.011), (I-655)+(1.079)+(17.012), (I-655)+(1.079)+(18.001),

(I-655)+(1.080)+(1.081), (I-655)+(1.080)+(1.082), (I-655)+(1.080)+(1.083), (I-655)+(1.080)+(1.084), (I-655)+(1.080)+(1.085), (I-655)+(1.080)+(1.086), (I-655)+(1.080)+(1.087), (I-655)+(1.080)+(1.088), (I-655)+(1.080)+(1.089), (I-655)+(1.080)+(1.090), (I-655)+(1.080)+(1.091), (I-655)+(1.080)+(1.092), (I-655)+(1.080)+(2.001), (I-655)+(1.080)+(2.002), (I-655)+(1.080)+(2.003), (I-655)+(1.080)+(2.004), (I-655)+(1.080)+(2.005), (I-655)+(1.080)+(2.006), (I-655)+(1.080)+(2.007), (I-655)+(1.080)+(2.008), (I-655)+(1.080)+(2.009), (I-655)+(1.080)+(2.010), (I-655)+(1.080)+(2.011), (I-655)+(1.080)+(2.012), (I-655)+(1.080)+(2.013), (I-655)+(1.080)+(2.014), (I-655)+(1.080)+(2.015), (I-655)+(1.080)+(2.016), (I-655)+(1.080)+(2.017), (I-655)+(1.080)+(2.018), (I-655)+(1.080)+(2.019), (I-655)+(1.080)+(2.020), (I-655)+(1.080)+(2.021), (I-655)+(1.080)+(2.022), (I-655)+(1.080)+(2.023), (I-655)+(1.080)+(2.024), (I-655)+(1.080)+(2.025), (I-655)+(1.080)+(2.026), (I-655)+(1.080)+(2.027), (I-655)+(1.080)+(2.028), (I-655)+(1.080)+(2.029), (I-655)+(1.080)+(2.030), (I-655)+(1.080)+(2.031), (I-655)+(1.080)+(2.032), (I-655)+(1.080)+(2.033), (I-655)+(1.080)+(2.034), (I-655)+(1.080)+(2.035), (I-655)+(1.080)+(2.036), (I-655)+(1.080)+(2.037), (I-655)+(1.080)+(2.038), (I-655)+(1.080)+(2.039), (I-655)+(1.080)+(2.040), (I-655)+(1.080)+(2.041), (I-655)+(1.080)+(2.042), (I-655)+(1.080)+(2.043), (I-655)+(1.080)+(2.044), (I-655)+(1.080)+(2.045), (I-655)+(1.080)+(2.046), (I-655)+(1.080)+(2.047), (I-655)+(1.080)+(2.048), (I-655)+(1.080)+(2.049), (I-655)+(1.080)+(2.050), (I-655)+(1.080)+(2.051), (I-655)+(1.080)+(2.052), (I-655)+(1.080)+(2.053), (I-655)+(1.080)+(2.054), (I-655)+(1.080)+(2.055), (I-655)+(1.080)+(2.056), (I-655)+(1.080)+(2.057), (I-655)+(1.080)+(2.058), (I-655)+(1.080)+(2.059), (I-655)+(1.080)+(3.001), (I-655)+(1.080)+(3.002), (I-655)+(1.080)+(3.003), (I-655)+(1.080)+(3.004), (I-655)+(1.080)+(3.005), (I-655)+(1.080)+(3.006), (I-655)+(1.080)+(3.007), (I-655)+(1.080)+(3.008), (I-655)+(1.080)+(3.009), (I-655)+(1.080)+(3.010), (I-655)+(1.080)+(3.011), (I-655)+(1.080)+(3.012), (I-655)+(1.080)+(3.013), (I-655)+(1.080)+(3.014), (I-655)+(1.080)+(3.015), (I-655)+(1.080)+(3.016), (I-655)+(1.080)+(3.017), (I-655)+(1.080)+(3.018), (I-655)+(1.080)+(3.019), (I-655)+(1.080)+(3.020), (I-655)+(1.080)+(3.021), (I-655)+(1.080)+(3.022), (I-655)+(1.080)+(3.023), (I-655)+(1.080)+(3.024), (I-655)+(1.080)+(3.025), (I-655)+(1.080)+(3.026), (I-655)+(1.080)+(3.027), (I-655)+(1.080)+(3.028), (I-655)+(1.080)+(3.029), (I-655)+(1.080)+(3.030), (I-655)+(1.080)+(3.031), (I-655)+(1.080)+(5.001), (I-655)+(1.080)+(5.002), (I-655)+(1.080)+(5.003), (I-655)+(1.080)+(5.004), (I-655)+(1.080)+(5.005), (I-655)+(1.080)+(5.006), (I-655)+(1.080)+(5.007), (I-655)+(1.080)+(5.008), (I-655)+(1.080)+(5.009), (I-655)+(1.080)+(5.010), (I-655)+(1.080)+(5.011), (I-655)+(1.080)+(5.012), (I-655)+(1.080)+(5.013), (I-655)+(1.080)+(5.014), (I-655)+(1.080)+(5.015), (I-655)+(1.080)+(5.016), (I-655)+(1.080)+(5.017), (I-655)+(1.080)+(5.018), (I-655)+(1.080)+(5.019), (I-655)+(1.080)+(5.020), (I-655)+(1.080)+(5.021), (I-655)+(1.080)+(5.022), (I-655)+(1.080)+(5.023), (I-655)+(1.080)+(6.001), (I-655)+(1.080)+(6.002), (I-655)+(1.080)+(6.003), (I-655)+(1.080)+(6.004), (I-655)+(1.080)+(7.001), (I-655)+(1.080)+(7.002), (I-655)+(1.080)+(7.003), (I-655)+(1.080)+(7.004), (I-655)+(1.080)+(7.005), (I-655)+(1.080)+(7.006), (I-655)+(1.080)+(9.001), (I-655)+(1.080)+(9.002), (I-655)+(1.080)+(9.003), (I-655)+(1.080)+(9.004), (I-655)+(1.080)+(9.005), (I-655)+(1.080)+(9.006), (I-655)+(1.080)+(9.007), (I-655)+(1.080)+(9.008), (I-655)+(1.080)+(9.009), (I-655)+(1.080)+(14.001), (I-655)+(1.080)+(14.002), (I-655)+(1.080)+(15.008), (I-655)+(1.080)+(15.011), (I-655)+(1.080)+(15.012), (I-655)+(1.080)+(15.016), (I-655)+(1.080)+(15.025), (I-655)+(1.080)+(15.027), (I-655)+(1.080)+(15.047), (I-655)+(1.080)+(15.063), (I-655)+(1.080)+(15.064), (I-655)+(1.080)+(16.001), (I-655)+(1.080)+(16.002), (I-655)+(1.080)+(16.003), (I-655)+(1.080)+(16.004), (I-655)+(1.080)+(16.005), (I-655)+(1.080)+(16.006), (I-655)+(1.080)+(16.007), (I-655)+(1.080)+(16.008), (I-655)+(1.080)+(17.001), (I-655)+(1.080)+(17.002), (I-655)+(1.080)+(17.003), (I-655)+(1.080)+(17.004), (I-655)+(1.080)+(17.005), (I-655)+(1.080)+(17.006), (I-655)+(1.080)+(17.007), (I-655)+(1.080)+(17.008), (I-655)+(1.080)+(17.009), (I-655)+(1.080)+(17.010), (I-655)+(1.080)+(17.011), (I-655)+(1.080)+(17.012), (I-655)+(1.080)+(18.001),

(I-655)+(1.081)+(1.082), (I-655)+(1.081)+(1.083), (I-655)+(1.081)+(1.084), (I-655)+(1.081)+(1.085), (I-655)+(1.081)+(1.086), (I-655)+(1.081)+(1.087), (I-655)+(1.081)+(1.088), (I-655)+(1.081)+(1.089), (I-655)+(1.081)+(1.090), (I-655)+(1.081)+(1.091), (I-655)+(1.081)+(1.092), (I-655)+(1.081)+(2.001), (I-655)+(1.081)+(2.002), (I-655)+(1.081)+(2.003), (I-655)+(1.081)+(2.004), (I-655)+(1.081)+(2.005), (I-655)+(1.081)+(2.006), (I-655)+(1.081)+(2.007), (I-655)+(1.081)+(2.008), (I-655)+(1.081)+(2.009), (I-655)+(1.081)+(2.010), (I-655)+(1.081)+(2.011), (I-655)+(1.081)+(2.012), (I-655)+(1.081)+(2.013), (I-655)+(1.081)+(2.014), (I-655)+(1.081)+(2.015), (I-655)+(1.081)+(2.016), (I-655)+(1.081)+(2.017), (I-655)+(1.081)+(2.018), (I-655)+(1.081)+(2.019), (I-655)+(1.081)+(2.020), (I-655)+(1.081)+(2.021), (I-655)+(1.081)+(2.022), (I-655)+(1.081)+(2.023), (I-655)+(1.081)+(2.024), (I-655)+(1.081)+(2.025), (I-655)+(1.081)+(2.026), (I-655)+(1.081)+(2.027), (I-655)+(1.081)+(2.028), (I-655)+(1.081)+(2.029), (I-655)+(1.081)+(2.030), (I-655)+(1.081)+(2.031), (I-655)+(1.081)+(2.032), (I-655)+(1.081)+(2.033), (I-655)+(1.081)+(2.034), (I-655)+(1.081)+(2.035), (I-655)+(1.081)+(2.036), (I-655)+(1.081)+(2.037), (I-655)+(1.081)+(2.038), (I-655)+(1.081)+(2.039), (I-655)+(1.081)+(2.040), (I-655)+(1.081)+(2.041), (I-655)+(1.081)+(2.042), (I-655)+(1.081)+(2.043), (I-655)+(1.081)+(2.044), (I-655)+(1.081)+(2.045), (I-655)+(1.081)+(2.046), (I-655)+(1.081)+(2.047), (I-655)+(1.081)+(2.048), (I-655)+(1.081)+(2.049), (I-655)+(1.081)+(2.050), (I-655)+(1.081)+(2.051), (I-655)+(1.081)+(2.052), (I-655)+(1.081)+(2.053), (I-655)+(1.081)+(2.054), (I-655)+(1.081)+(2.055), (I-655)+(1.081)+(2.056), (I-655)+(1.081)+(2.057), (I-655)+(1.081)+(2.058), (I-655)+(1.081)+(2.059), (I-655)+(1.081)+(3.001), (I-655)+(1.081)+(3.002), (I-655)+(1.081)+(3.003), (I-655)+(1.081)+(3.004), (I-655)+(1.081)+(3.005), (I-655)+(1.081)+(3.006), (I-655)+(1.081)+(3.007), (I-655)+(1.081)+(3.008), (I-655)+(1.081)+(3.009), (I-655)+(1.081)+(3.010), (I-655)+(1.081)+(3.011), (I-655)+(1.081)+(3.012), (I-655)+(1.081)+(3.013), (I-655)+(1.081)+(3.014), (I-655)+(1.081)+(3.015), (I-655)+(1.081)+(3.016), (I-655)+(1.081)+(3.017), (I-655)+(1.081)+(3.018), (I-655)+(1.081)+(3.019), (I-655)+(1.081)+(3.020), (I-655)+(1.081)+(3.021), (I-655)+(1.081)+(3.022), (I-655)+(1.081)+(3.023), (I-655)+(1.081)+(3.024), (I-655)+(1.081)+(3.025), (I-655)+(1.081)+(3.026), (I-655)+(1.081)+(3.027), (I-655)+(1.081)+(3.028), (I-655)+(1.081)+(3.029), (I-655)+(1.081)+(3.030), (I-655)+(1.081)+(3.031), (I-655)+(1.081)+(5.001), (I-655)+(1.081)+(5.002), (I-655)+(1.081)+(5.003), (I-655)+(1.081)+(5.004), (I-655)+(1.081)+(5.005), (I-655)+(1.081)+(5.006), (I-655)+(1.081)+(5.007), (I-655)+(1.081)+(5.008), (I-655)+(1.081)+(5.009), (I-655)+(1.081)+(5.010), (I-655)+(1.081)+(5.011), (I-655)+(1.081)+(5.012), (I-655)+(1.081)+(5.013), (I-655)+(1.081)+(5.014), (I-655)+(1.081)+(5.015), (I-655)+(1.081)+(5.016), (I-655)+(1.081)+(5.017), (I-655)+(1.081)+(5.018), (I-655)+(1.081)+(5.019), (I-655)+(1.081)+(5.020), (I-655)+(1.081)+(5.021), (I-655)+(1.081)+(5.022), (I-655)+(1.081)+(5.023), (I-655)+(1.081)+(6.001), (I-655)+(1.081)+(6.002), (I-655)+(1.081)+(6.003), (I-655)+(1.081)+(6.004), (I-655)+(1.081)+(7.001), (I-655)+(1.081)+(7.002), (I-655)+(1.081)+(7.003), (I-655)+(1.081)+(7.004), (I-655)+(1.081)+(7.005), (I-655)+(1.081)+(7.006), (I-655)+(1.081)+(9.001), (I-655)+(1.081)+(9.002), (I-655)+(1.081)+(9.003), (I-655)+(1.081)+(9.004), (I-655)+(1.081)+(9.005), (I-655)+(1.081)+(9.006), (I-655)+(1.081)+(9.007), (I-655)+(1.081)+(9.008), (I-655)+(1.081)+(9.009), (I-655)+(1.081)+(14.001), (I-655)+(1.081)+(14.002), (I-655)+(1.081)+(15.008), (I-655)+(1.081)+(15.011), (I-655)+(1.081)+(15.012), (I-655)+(1.081)+(15.016), (I-655)+(1.081)+(15.025), (I-655)+(1.081)+(15.027), (I-655)+(1.081)+(15.047), (I-655)+(1.081)+(15.063), (I-655)+(1.081)+(15.064), (I-655)+(1.081)+(16.001), (I-655)+(1.081)+(16.002), (I-655)+(1.081)+(16.003), (I-655)+(1.081)+(16.004), (I-655)+(1.081)+(16.005), (I-655)+(1.081)+(16.006), (I-655)+(1.081)+(16.007), (I-655)+(1.081)+(16.008), (I-655)+(1.081)+(17.001), (I-655)+(1.081)+(17.002), (I-655)+(1.081)+(17.003), (I-655)+(1.081)+(17.004), (I-655)+(1.081)+(17.005), (I-655)+(1.081)+(17.006), (I-655)+(1.081)+(17.007), (I-655)+(1.081)+(17.008), (I-655)+(1.081)+(17.009), (I-655)+(1.081)+(17.010), (I-655)+(1.081)+(17.011), (I-655)+(1.081)+(17.012), (I-655)+(1.081)+(18.001),

(I-655)+(1.082)+(1.083), (I-655)+(1.082)+(1.084), (I-655)+(1.082)+(1.085), (I-655)+(1.082)+(1.086), (I-655)+(1.082)+(1.087), (I-655)+(1.082)+(1.088), (I-655)+(1.082)+(1.089), (I-655)+(1.082)+(1.090), (I-655)+(1.082)+(1.091), (I-655)+(1.082)+(1.092), (I-655)+(1.082)+(2.001), (I-655)+(1.082)+(2.002), (I-655)+(1.082)+(2.003), (I-655)+(1.082)+(2.004), (I-655)+(1.082)+(2.005), (I-655)+(1.082)+(2.006), (I-655)+(1.082)+(2.007), (I-655)+(1.082)+(2.008), (I-655)+(1.082)+(2.009), (I-655)+(1.082)+(2.010), (I-655)+(1.082)+(2.011), (I-655)+(1.082)+(2.012), (I-655)+(1.082)+(2.013), (I-655)+(1.082)+(2.014), (I-655)+(1.082)+(2.015), (I-655)+(1.082)+(2.016), (I-655)+(1.082)+(2.017), (I-655)+(1.082)+(2.018), (I-655)+(1.082)+(2.019), (I-655)+(1.082)+(2.020), (I-655)+(1.082)+(2.021), (I-655)+(1.082)+(2.022), (I-655)+(1.082)+(2.023), (I-655)+(1.082)+(2.024), (I-655)+(1.082)+(2.025), (I-655)+(1.082)+(2.026), (I-655)+(1.082)+(2.027), (I-655)+(1.082)+(2.028), (I-655)+(1.082)+(2.029), (I-655)+(1.082)+(2.030), (I-655)+(1.082)+(2.031), (I-655)+(1.082)+(2.032), (I-655)+(1.082)+(2.033), (I-655)+(1.082)+(2.034), (I-655)+(1.082)+(2.035), (I-655)+(1.082)+(2.036), (I-655)+(1.082)+(2.037), (I-655)+(1.082)+(2.038), (I-655)+(1.082)+(2.039), (I-655)+(1.082)+(2.040), (I-655)+(1.082)+(2.041), (I-655)+(1.082)+(2.042), (I-655)+(1.082)+(2.043), (I-655)+(1.082)+(2.044), (I-655)+(1.082)+(2.045), (I-655)+(1.082)+(2.046), (I-655)+(1.082)+(2.047), (I-655)+(1.082)+(2.048), (I-655)+(1.082)+(2.049), (I-655)+(1.082)+(2.050), (I-655)+(1.082)+(2.051), (I-655)+(1.082)+(2.052), (I-655)+(1.082)+(2.053), (I-655)+(1.082)+(2.054), (I-655)+(1.082)+(2.055), (I-655)+(1.082)+(2.056), (I-655)+(1.082)+(2.057), (I-655)+(1.082)+(2.058), (I-655)+(1.082)+(2.059), (I-655)+(1.082)+(3.001), (I-655)+(1.082)+(3.002), (I-655)+(1.082)+(3.003), (I-655)+(1.082)+(3.004), (I-655)+(1.082)+(3.005), (I-655)+(1.082)+(3.006), (I-655)+(1.082)+(3.007), (I-655)+(1.082)+(3.008), (I-655)+(1.082)+(3.009), (I-655)+(1.082)+(3.010), (I-655)+(1.082)+(3.011), (I-655)+(1.082)+(3.012), (I-655)+(1.082)+(3.013), (I-655)+(1.082)+(3.014), (I-655)+(1.082)+(3.015), (I-655)+(1.082)+(3.016), (I-655)+(1.082)+(3.017), (I-655)+(1.082)+(3.018), (I-655)+(1.082)+(3.019), (I-655)+(1.082)+(3.020), (I-655)+(1.082)+(3.021), (I-655)+(1.082)+(3.022), (I-655)+(1.082)+(3.023), (I-655)+(1.082)+(3.024), (I-655)+(1.082)+(3.025), (I-655)+(1.082)+(3.026), (I-655)+(1.082)+(3.027), (I-655)+(1.082)+(3.028), (I-655)+(1.082)+(3.029), (I-655)+(1.082)+(3.030), (I-655)+(1.082)+(3.031), (I-655)+(1.082)+(5.001), (I-655)+(1.082)+(5.002), (I-655)+(1.082)+(5.003), (I-655)+(1.082)+(5.004), (I-655)+(1.082)+(5.005), (I-655)+(1.082)+(5.006), (I-655)+(1.082)+(5.007), (I-655)+(1.082)+(5.008), (I-655)+(1.082)+(5.009), (I-655)+(1.082)+(5.010), (I-655)+(1.082)+(5.011), (I-655)+(1.082)+(5.012), (I-655)+(1.082)+(5.013), (I-655)+(1.082)+(5.014), (I-655)+(1.082)+(5.015), (I-655)+(1.082)+(5.016), (I-655)+(1.082)+(5.017), (I-655)+(1.082)+(5.018), (I-655)+(1.082)+(5.019), (I-655)+(1.082)+(5.020), (I-655)+(1.082)+(5.021), (I-655)+(1.082)+(5.022), (I-655)+(1.082)+(5.023), (I-655)+(1.082)+(6.001), (I-655)+(1.082)+(6.002), (I-655)+(1.082)+(6.003), (I-655)+(1.082)+(6.004), (I-655)+(1.082)+(7.001), (I-655)+(1.082)+(7.002), (I-655)+(1.082)+(7.003), (I-655)+(1.082)+(7.004), (I-655)+(1.082)+(7.005), (I-655)+(1.082)+(7.006), (I-655)+(1.082)+(9.001), (I-655)+(1.082)+(9.002), (I-655)+(1.082)+(9.003), (I-655)+(1.082)+(9.004), (I-655)+(1.082)+(9.005), (I-655)+(1.082)+(9.006), (I-655)+(1.082)+(9.007), (I-655)+(1.082)+(9.008), (I-655)+(1.082)+(9.009), (I-655)+(1.082)+(14.001), (I-655)+(1.082)+(14.002), (I-655)+(1.082)+(15.008), (I-655)+(1.082)+(15.011), (I-655)+(1.082)+(15.012), (I-655)+(1.082)+(15.016), (I-655)+(1.082)+(15.025), (I-655)+(1.082)+(15.027), (I-655)+(1.082)+(15.047), (I-655)+(1.082)+(15.063), (I-655)+(1.082)+(15.064), (I-655)+(1.082)+(16.001), (I-655)+(1.082)+(16.002), (I-655)+(1.082)+(16.003), (I-655)+(1.082)+(16.004), (I-655)+(1.082)+(16.005), (I-655)+(1.082)+(16.006), (I-655)+(1.082)+(16.007), (I-655)+(1.082)+(16.008), (I-655)+(1.082)+(17.001), (I-655)+(1.082)+(17.002), (I-655)+(1.082)+(17.003), (I-655)+(1.082)+(17.004), (I-655)+(1.082)+(17.005), (I-655)+(1.082)+(17.006), (I-655)+(1.082)+(17.007), (I-655)+(1.082)+(17.008), (I-655)+(1.082)+(17.009), (I-655)+(1.082)+(17.010), (I-655)+(1.082)+(17.011), (I-655)+(1.082)+(17.012), (I-655)+(1.082)+(18.001),

(I-655)+(1.083)+(1.084), (I-655)+(1.083)+(1.085), (I-655)+(1.083)+(1.086), (I-655)+(1.083)+(1.087), (I-655)+(1.083)+(1.088), (I-655)+(1.083)+(1.089), (I-655)+(1.083)+(1.090), (I-655)+(1.083)+(1.091), (I-655)+(1.083)+(1.092), (I-655)+(1.083)+(2.001), (I-655)+(1.083)+(2.002), (I-655)+(1.083)+(2.003), (I-655)+(1.083)+(2.004), (I-655)+(1.083)+(2.005), (I-655)+(1.083)+(2.006), (I-655)+(1.083)+(2.007), (I-655)+(1.083)+(2.008), (I-655)+(1.083)+(2.009), (I-655)+(1.083)+(2.010), (I-655)+(1.083)+(2.011), (I-655)+(1.083)+(2.012), (I-655)+(1.083)+(2.013), (I-655)+(1.083)+(2.014), (I-655)+(1.083)+(2.015), (I-655)+(1.083)+(2.016), (I-655)+(1.083)+(2.017), (I-655)+(1.083)+(2.018), (I-655)+(1.083)+(2.019), (I-655)+(1.083)+(2.020), (I-655)+(1.083)+(2.021), (I-655)+(1.083)+(2.022), (I-655)+(1.083)+(2.023), (I-655)+(1.083)+(2.024), (I-655)+(1.083)+(2.025), (I-655)+(1.083)+(2.026), (I-655)+(1.083)+(2.027), (I-655)+(1.083)+(2.028), (I-655)+(1.083)+(2.029), (I-655)+(1.083)+(2.030), (I-655)+(1.083)+(2.031), (I-655)+(1.083)+(2.032), (I-655)+(1.083)+(2.033), (I-655)+(1.083)+(2.034), (I-655)+(1.083)+(2.035), (I-655)+(1.083)+(2.036), (I-655)+(1.083)+(2.037), (I-655)+(1.083)+(2.038), (I-655)+(1.083)+(2.039), (I-655)+(1.083)+(2.040), (I-655)+(1.083)+(2.041), (I-655)+(1.083)+(2.042), (I-655)+(1.083)+(2.043), (I-655)+(1.083)+(2.044), (I-655)+(1.083)+(2.045), (I-655)+(1.083)+(2.046), (I-655)+(1.083)+(2.047), (I-655)+(1.083)+(2.048), (I-655)+(1.083)+(2.049), (I-655)+(1.083)+(2.050), (I-655)+(1.083)+(2.051), (I-655)+(1.083)+(2.052), (I-655)+(1.083)+(2.053), (I-655)+(1.083)+(2.054), (I-655)+(1.083)+(2.055), (I-655)+(1.083)+(2.056), (I-655)+(1.083)+(2.057), (I-655)+(1.083)+(2.058), (I-655)+(1.083)+(2.059), (I-655)+(1.083)+(3.001), (I-655)+(1.083)+(3.002), (I-655)+(1.083)+(3.003), (I-655)+(1.083)+(3.004), (I-655)+(1.083)+(3.005), (I-655)+(1.083)+(3.006), (I-655)+(1.083)+(3.007), (I-655)+(1.083)+(3.008), (I-655)+(1.083)+(3.009), (I-655)+(1.083)+(3.010), (I-655)+(1.083)+(3.011), (I-655)+(1.083)+(3.012), (I-655)+(1.083)+(3.013), (I-655)+(1.083)+(3.014), (I-655)+(1.083)+(3.015), (I-655)+(1.083)+(3.016), (I-655)+(1.083)+(3.017), (I-655)+(1.083)+(3.018), (I-655)+(1.083)+(3.019), (I-655)+(1.083)+(3.020), (I-655)+(1.083)+(3.021), (I-655)+(1.083)+(3.022), (I-655)+(1.083)+(3.023), (I-655)+(1.083)+(3.024), (I-655)+(1.083)+(3.025), (I-655)+(1.083)+(3.026), (I-655)+(1.083)+(3.027), (I-655)+(1.083)+(3.028), (I-655)+(1.083)+(3.029), (I-655)+(1.083)+(3.030), (I-655)+(1.083)+(3.031), (I-655)+(1.083)+(5.001), (I-655)+(1.083)+(5.002), (I-655)+(1.083)+(5.003), (I-655)+(1.083)+(5.004), (I-655)+(1.083)+(5.005), (I-655)+(1.083)+(5.006), (I-655)+(1.083)+(5.007), (I-655)+(1.083)+(5.008), (I-655)+(1.083)+(5.009), (I-655)+(1.083)+(5.010), (I-655)+(1.083)+(5.011), (I-655)+(1.083)+(5.012), (I-655)+(1.083)+(5.013), (I-655)+(1.083)+(5.014), (I-655)+(1.083)+(5.015), (I-655)+(1.083)+(5.016), (I-655)+(1.083)+(5.017), (I-655)+(1.083)+(5.018), (I-655)+(1.083)+(5.019), (I-655)+(1.083)+(5.020), (I-655)+(1.083)+(5.021), (I-655)+(1.083)+(5.022), (I-655)+(1.083)+(5.023), (I-655)+(1.083)+(6.001), (I-655)+(1.083)+(6.002), (I-655)+(1.083)+(6.003), (I-655)+(1.083)+(6.004), (I-655)+(1.083)+(7.001), (I-655)+(1.083)+(7.002), (I-655)+(1.083)+(7.003), (I-655)+(1.083)+(7.004), (I-655)+(1.083)+(7.005), (I-655)+(1.083)+(7.006), (I-655)+(1.083)+(9.001), (I-655)+(1.083)+(9.002), (I-655)+(1.083)+(9.003), (I-655)+(1.083)+(9.004), (I-655)+(1.083)+(9.005), (I-655)+(1.083)+(9.006), (I-655)+(1.083)+(9.007), (I-655)+(1.083)+(9.008), (I-655)+(1.083)+(9.009), (I-655)+(1.083)+(14.001), (I-655)+(1.083)+(14.002), (I-655)+(1.083)+(15.008), (I-655)+(1.083)+(15.011), (I-655)+(1.083)+(15.012), (I-655)+(1.083)+(15.016), (I-655)+(1.083)+(15.025), (I-655)+(1.083)+(15.027), (I-655)+(1.083)+(15.047), (I-655)+(1.083)+(15.063), (I-655)+(1.083)+(15.064), (I-655)+(1.083)+(16.001), (I-655)+(1.083)+(16.002), (I-655)+(1.083)+(16.003), (I-655)+(1.083)+(16.004), (I-655)+(1.083)+(16.005), (I-655)+(1.083)+(16.006), (I-655)+(1.083)+(16.007), (I-655)+(1.083)+(16.008), (I-655)+(1.083)+(17.001), (I-655)+(1.083)+(17.002), (I-655)+(1.083)+(17.003), (I-655)+(1.083)+(17.004), (I-655)+(1.083)+(17.005), (I-655)+(1.083)+(17.006), (I-655)+(1.083)+(17.007), (I-655)+(1.083)+(17.008), (I-655)+(1.083)+(17.009), (I-655)+(1.083)+(17.010), (I-655)+(1.083)+(17.011), (I-655)+(1.083)+(17.012), (I-655)+(1.083)+(18.001),

(I-655)+(1.084)+(1.085), (I-655)+(1.084)+(1.086), (I-655)+(1.084)+(1.087), (I-655)+(1.084)+(1.088), (I-655)+(1.084)+(1.089), (I-655)+(1.084)+(1.090), (I-655)+(1.084)+(1.091), (I-655)+(1.084)+(1.092), (I-655)+(1.084)+(2.001), (I-655)+(1.084)+(2.002), (I-655)+(1.084)+(2.003), (I-655)+(1.084)+(2.004), (I-655)+(1.084)+(2.005), (I-655)+(1.084)+(2.006), (I-655)+(1.084)+(2.007), (I-655)+(1.084)+(2.008), (I-655)+(1.084)+(2.009), (I-655)+(1.084)+(2.010), (I-655)+(1.084)+(2.011), (I-655)+(1.084)+(2.012), (I-655)+(1.084)+(2.013), (I-655)+(1.084)+(2.014), (I-655)+(1.084)+(2.015), (I-655)+(1.084)+(2.016), (I-655)+(1.084)+(2.017), (I-655)+(1.084)+(2.018), (I-655)+(1.084)+(2.019), (I-655)+(1.084)+(2.020), (I-655)+(1.084)+(2.021), (I-655)+(1.084)+(2.022), (I-655)+(1.084)+(2.023), (I-655)+(1.084)+(2.024), (I-655)+(1.084)+(2.025), (I-655)+(1.084)+(2.026), (I-655)+(1.084)+(2.027), (I-655)+(1.084)+(2.028), (I-655)+(1.084)+(2.029), (I-655)+(1.084)+(2.030), (I-655)+(1.084)+(2.031), (I-655)+(1.084)+(2.032), (I-655)+(1.084)+(2.033), (I-655)+(1.084)+(2.034), (I-655)+(1.084)+(2.035), (I-655)+(1.084)+(2.036), (I-655)+(1.084)+(2.037), (I-655)+(1.084)+(2.038), (I-655)+(1.084)+(2.039), (I-655)+(1.084)+(2.040), (I-655)+(1.084)+(2.041), (I-655)+(1.084)+(2.042), (I-655)+(1.084)+(2.043), (I-655)+(1.084)+(2.044), (I-655)+(1.084)+(2.045), (I-655)+(1.084)+(2.046), (I-655)+(1.084)+(2.047), (I-655)+(1.084)+(2.048), (I-655)+(1.084)+(2.049), (I-655)+(1.084)+(2.050), (I-655)+(1.084)+(2.051), (I-655)+(1.084)+(2.052), (I-655)+(1.084)+(2.053), (I-655)+(1.084)+(2.054), (I-655)+(1.084)+(2.055), (I-655)+(1.084)+(2.056), (I-655)+(1.084)+(2.057), (I-655)+(1.084)+(2.058), (I-655)+(1.084)+(2.059), (I-655)+(1.084)+(3.001), (I-655)+(1.084)+(3.002), (I-655)+(1.084)+(3.003), (I-655)+(1.084)+(3.004), (I-655)+(1.084)+(3.005), (I-655)+(1.084)+(3.006), (I-655)+(1.084)+(3.007), (I-655)+(1.084)+(3.008), (I-655)+(1.084)+(3.009), (I-655)+(1.084)+(3.010), (I-655)+(1.084)+(3.011), (I-655)+(1.084)+(3.012), (I-655)+(1.084)+(3.013), (I-655)+(1.084)+(3.014), (I-655)+(1.084)+(3.015), (I-655)+(1.084)+(3.016), (I-655)+(1.084)+(3.017), (I-655)+(1.084)+(3.018), (I-655)+(1.084)+(3.019), (I-655)+(1.084)+(3.020), (I-655)+(1.084)+(3.021), (I-655)+(1.084)+(3.022), (I-655)+(1.084)+(3.023), (I-655)+(1.084)+(3.024), (I-655)+(1.084)+(3.025), (I-655)+(1.084)+(3.026), (I-655)+(1.084)+(3.027), (I-655)+(1.084)+(3.028), (I-655)+(1.084)+(3.029), (I-655)+(1.084)+(3.030), (I-655)+(1.084)+(3.031), (I-655)+(1.084)+(5.001), (I-655)+(1.084)+(5.002), (I-655)+(1.084)+(5.003), (I-655)+(1.084)+(5.004), (I-655)+(1.084)+(5.005), (I-655)+(1.084)+(5.006), (I-655)+(1.084)+(5.007), (I-655)+(1.084)+(5.008), (I-655)+(1.084)+(5.009), (I-655)+(1.084)+(5.010), (I-655)+(1.084)+(5.011), (I-655)+(1.084)+(5.012), (I-655)+(1.084)+(5.013), (I-655)+(1.084)+(5.014), (I-655)+(1.084)+(5.015), (I-655)+(1.084)+(5.016), (I-655)+(1.084)+(5.017), (I-655)+(1.084)+(5.018), (I-655)+(1.084)+(5.019), (I-655)+(1.084)+(5.020), (I-655)+(1.084)+(5.021), (I-655)+(1.084)+(5.022), (I-655)+(1.084)+(5.023), (I-655)+(1.084)+(6.001), (I-655)+(1.084)+(6.002), (I-655)+(1.084)+(6.003), (I-655)+(1.084)+(6.004), (I-655)+(1.084)+(7.001), (I-655)+(1.084)+(7.002), (I-655)+(1.084)+(7.003), (I-655)+(1.084)+(7.004), (I-655)+(1.084)+(7.005), (I-655)+(1.084)+(7.006), (I-655)+(1.084)+(9.001), (I-655)+(1.084)+(9.002), (I-655)+(1.084)+(9.003), (I-655)+(1.084)+(9.004), (I-655)+(1.084)+(9.005), (I-655)+(1.084)+(9.006), (I-655)+(1.084)+(9.007), (I-655)+(1.084)+(9.008), (I-655)+(1.084)+(9.009), (I-655)+(1.084)+(14.001), (I-655)+(1.084)+(14.002), (I-655)+(1.084)+(15.008), (I-655)+(1.084)+(15.011), (I-655)+(1.084)+(15.012), (I-655)+(1.084)+(15.016), (I-655)+(1.084)+(15.025), (I-655)+(1.084)+(15.027), (I-655)+(1.084)+(15.047), (I-655)+(1.084)+(15.063), (I-655)+(1.084)+(15.064), (I-655)+(1.084)+(16.001), (I-655)+(1.084)+(16.002), (I-655)+(1.084)+(16.003), (I-655)+(1.084)+(16.004), (I-655)+(1.084)+(16.005), (I-655)+(1.084)+(16.006), (I-655)+(1.084)+(16.007), (I-655)+(1.084)+(16.008), (I-655)+(1.084)+(17.001), (I-655)+(1.084)+(17.002), (I-655)+(1.084)+(17.003), (I-655)+(1.084)+(17.004), (I-655)+(1.084)+(17.005), (I-655)+(1.084)+(17.006), (I-655)+(1.084)+(17.007), (I-655)+(1.084)+(17.008), (I-655)+(1.084)+(17.009), (I-655)+(1.084)+(17.010), (I-655)+(1.084)+(17.011), (I-655)+(1.084)+(17.012), (I-655)+(1.084)+(18.001),

(I-655)+(1.085)+(1.086), (I-655)+(1.085)+(1.087), (I-655)+(1.085)+(1.088), (I-655)+(1.085)+(1.089), (I-655)+(1.085)+(1.090), (I-655)+(1.085)+(1.091), (I-655)+(1.085)+(1.092), (I-655)+(1.085)+(2.001), (I-655)+(1.085)+(2.002), (I-655)+(1.085)+(2.003), (I-655)+(1.085)+(2.004), (I-655)+(1.085)+(2.005), (I-655)+(1.085)+(2.006), (I-655)+(1.085)+(2.007), (I-655)+(1.085)+(2.008), (I-655)+(1.085)+(2.009), (I-655)+(1.085)+(2.010), (I-655)+(1.085)+(2.011), (I-655)+(1.085)+(2.012), (I-655)+(1.085)+(2.013), (I-655)+(1.085)+(2.014), (I-655)+(1.085)+(2.015), (I-655)+(1.085)+(2.016), (I-655)+(1.085)+(2.017), (I-655)+(1.085)+(2.018), (I-655)+(1.085)+(2.019), (I-655)+(1.085)+(2.020), (I-655)+(1.085)+(2.021), (I-655)+(1.085)+(2.022), (I-655)+(1.085)+(2.023), (I-655)+(1.085)+(2.024), (I-655)+(1.085)+(2.025), (I-655)+(1.085)+(2.026), (I-655)+(1.085)+(2.027), (I-655)+(1.085)+(2.028), (I-655)+(1.085)+(2.029), (I-655)+(1.085)+(2.030), (I-655)+(1.085)+(2.031), (I-655)+(1.085)+(2.032), (I-655)+(1.085)+(2.033), (I-655)+(1.085)+(2.034), (I-655)+(1.085)+(2.035), (I-655)+(1.085)+(2.036), (I-655)+(1.085)+(2.037), (I-655)+(1.085)+(2.038), (I-655)+(1.085)+(2.039), (I-655)+(1.085)+(2.040), (I-655)+(1.085)+(2.041), (I-655)+(1.085)+(2.042), (I-655)+(1.085)+(2.043), (I-655)+(1.085)+(2.044), (I-655)+(1.085)+(2.045), (I-655)+(1.085)+(2.046), (I-655)+(1.085)+(2.047), (I-655)+(1.085)+(2.048), (I-655)+(1.085)+(2.049), (I-655)+(1.085)+(2.050), (I-655)+(1.085)+(2.051), (I-655)+(1.085)+(2.052), (I-655)+(1.085)+(2.053), (I-655)+(1.085)+(2.054), (I-655)+(1.085)+(2.055), (I-655)+(1.085)+(2.056), (I-655)+(1.085)+(2.057), (I-655)+(1.085)+(2.058), (I-655)+(1.085)+(2.059), (I-655)+(1.085)+(3.001), (I-655)+(1.085)+(3.002), (I-655)+(1.085)+(3.003), (I-655)+(1.085)+(3.004), (I-655)+(1.085)+(3.005), (I-655)+(1.085)+(3.006), (I-655)+(1.085)+(3.007), (I-655)+(1.085)+(3.008), (I-655)+(1.085)+(3.009), (I-655)+(1.085)+(3.010), (I-655)+(1.085)+(3.011), (I-655)+(1.085)+(3.012), (I-655)+(1.085)+(3.013), (I-655)+(1.085)+(3.014), (I-655)+(1.085)+(3.015), (I-655)+(1.085)+(3.016), (I-655)+(1.085)+(3.017), (I-655)+(1.085)+(3.018), (I-655)+(1.085)+(3.019), (I-655)+(1.085)+(3.020), (I-655)+(1.085)+(3.021), (I-655)+(1.085)+(3.022), (I-655)+(1.085)+(3.023), (I-655)+(1.085)+(3.024), (I-655)+(1.085)+(3.025), (I-655)+(1.085)+(3.026), (I-655)+(1.085)+(3.027), (I-655)+(1.085)+(3.028), (I-655)+(1.085)+(3.029), (I-655)+(1.085)+(3.030), (I-655)+(1.085)+(3.031), (I-655)+(1.085)+(5.001), (I-655)+(1.085)+(5.002), (I-655)+(1.085)+(5.003), (I-655)+(1.085)+(5.004), (I-655)+(1.085)+(5.005), (I-655)+(1.085)+(5.006), (I-655)+(1.085)+(5.007), (I-655)+(1.085)+(5.008), (I-655)+(1.085)+(5.009), (I-655)+(1.085)+(5.010), (I-655)+(1.085)+(5.011), (I-655)+(1.085)+(5.012), (I-655)+(1.085)+(5.013), (I-655)+(1.085)+(5.014), (I-655)+(1.085)+(5.015), (I-655)+(1.085)+(5.016), (I-655)+(1.085)+(5.017), (I-655)+(1.085)+(5.018), (I-655)+(1.085)+(5.019), (I-655)+(1.085)+(5.020), (I-655)+(1.085)+(5.021), (I-655)+(1.085)+(5.022), (I-655)+(1.085)+(5.023), (I-655)+(1.085)+(6.001), (I-655)+(1.085)+(6.002), (I-655)+(1.085)+(6.003), (I-655)+(1.085)+(6.004), (I-655)+(1.085)+(7.001), (I-655)+(1.085)+(7.002), (I-655)+(1.085)+(7.003), (I-655)+(1.085)+(7.004), (I-655)+(1.085)+(7.005), (I-655)+(1.085)+(7.006), (I-655)+(1.085)+(9.001), (I-655)+(1.085)+(9.002), (I-655)+(1.085)+(9.003), (I-655)+(1.085)+(9.004), (I-655)+(1.085)+(9.005), (I-655)+(1.085)+(9.006), (I-655)+(1.085)+(9.007), (I-655)+(1.085)+(9.008), (I-655)+(1.085)+(9.009), (I-655)+(1.085)+(14.001), (I-655)+(1.085)+(14.002), (I-655)+(1.085)+(15.008), (I-655)+(1.085)+(15.011), (I-655)+(1.085)+(15.012), (I-655)+(1.085)+(15.016), (I-655)+(1.085)+(15.025), (I-655)+(1.085)+(15.027), (I-655)+(1.085)+(15.047), (I-655)+(1.085)+(15.063), (I-655)+(1.085)+(15.064), (I-655)+(1.085)+(16.001), (I-655)+(1.085)+(16.002), (I-655)+(1.085)+(16.003), (I-655)+(1.085)+(16.004), (I-655)+(1.085)+(16.005), (I-655)+(1.085)+(16.006), (I-655)+(1.085)+(16.007), (I-655)+(1.085)+(16.008), (I-655)+(1.085)+(17.001), (I-655)+(1.085)+(17.002), (I-655)+(1.085)+(17.003), (I-655)+(1.085)+(17.004), (I-655)+(1.085)+(17.005), (I-655)+(1.085)+(17.006), (I-655)+(1.085)+(17.007), (I-655)+(1.085)+(17.008), (I-655)+(1.085)+(17.009), (I-655)+(1.085)+(17.010), (I-655)+(1.085)+(17.011), (I-655)+(1.085)+(17.012), (I-655)+(1.085)+(18.001),

(I-655)+(1.086)+(1.087), (I-655)+(1.086)+(1.088), (I-655)+(1.086)+(1.089), (I-655)+(1.086)+(1.090), (I-655)+(1.086)+(1.091), (I-655)+(1.086)+(1.092), (I-655)+(1.086)+(2.001), (I-655)+(1.086)+(2.002), (I-655)+(1.086)+(2.003), (I-655)+(1.086)+(2.004), (I-655)+(1.086)+(2.005), (I-655)+(1.086)+(2.006), (I-655)+(1.086)+(2.007), (I-655)+(1.086)+(2.008), (I-655)+(1.086)+(2.009), (I-655)+(1.086)+(2.010), (I-655)+(1.086)+(2.011), (I-655)+(1.086)+(2.012), (I-655)+(1.086)+(2.013), (I-655)+(1.086)+(2.014), (I-655)+(1.086)+(2.015), (I-655)+(1.086)+(2.016), (I-655)+(1.086)+(2.017), (I-655)+(1.086)+(2.018), (I-655)+(1.086)+(2.019), (I-655)+(1.086)+(2.020), (I-655)+(1.086)+(2.021), (I-655)+(1.086)+(2.022), (I-655)+(1.086)+(2.023), (I-655)+(1.086)+(2.024), (I-655)+(1.086)+(2.025), (I-655)+(1.086)+(2.026), (I-655)+(1.086)+(2.027), (I-655)+(1.086)+(2.028), (I-655)+(1.086)+(2.029), (I-655)+(1.086)+(2.030), (I-655)+(1.086)+(2.031), (I-655)+(1.086)+(2.032), (I-655)+(1.086)+(2.033), (I-655)+(1.086)+(2.034), (I-655)+(1.086)+(2.035), (I-655)+(1.086)+(2.036), (I-655)+(1.086)+(2.037), (I-655)+(1.086)+(2.038), (I-655)+(1.086)+(2.039), (I-655)+(1.086)+(2.040), (I-655)+(1.086)+(2.041), (I-655)+(1.086)+(2.042), (I-655)+(1.086)+(2.043), (I-655)+(1.086)+(2.044), (I-655)+(1.086)+(2.045), (I-655)+(1.086)+(2.046), (I-655)+(1.086)+(2.047), (I-655)+(1.086)+(2.048), (I-655)+(1.086)+(2.049), (I-655)+(1.086)+(2.050), (I-655)+(1.086)+(2.051), (I-655)+(1.086)+(2.052), (I-655)+(1.086)+(2.053), (I-655)+(1.086)+(2.054), (I-655)+(1.086)+(2.055), (I-655)+(1.086)+(2.056), (I-655)+(1.086)+(2.057), (I-655)+(1.086)+(2.058), (I-655)+(1.086)+(2.059), (I-655)+(1.086)+(3.001), (I-655)+(1.086)+(3.002), (I-655)+(1.086)+(3.003), (I-655)+(1.086)+(3.004), (I-655)+(1.086)+(3.005), (I-655)+(1.086)+(3.006), (I-655)+(1.086)+(3.007), (I-655)+(1.086)+(3.008), (I-655)+(1.086)+(3.009), (I-655)+(1.086)+(3.010), (I-655)+(1.086)+(3.011), (I-655)+(1.086)+(3.012), (I-655)+(1.086)+(3.013), (I-655)+(1.086)+(3.014), (I-655)+(1.086)+(3.015), (I-655)+(1.086)+(3.016), (I-655)+(1.086)+(3.017), (I-655)+(1.086)+(3.018), (I-655)+(1.086)+(3.019), (I-655)+(1.086)+(3.020), (I-655)+(1.086)+(3.021), (I-655)+(1.086)+(3.022), (I-655)+(1.086)+(3.023), (I-655)+(1.086)+(3.024), (I-655)+(1.086)+(3.025), (I-655)+(1.086)+(3.026), (I-655)+(1.086)+(3.027), (I-655)+(1.086)+(3.028), (I-655)+(1.086)+(3.029), (I-655)+(1.086)+(3.030), (I-655)+(1.086)+(3.031), (I-655)+(1.086)+(5.001), (I-655)+(1.086)+(5.002), (I-655)+(1.086)+(5.003), (I-655)+(1.086)+(5.004), (I-655)+(1.086)+(5.005), (I-655)+(1.086)+(5.006), (I-655)+(1.086)+(5.007), (I-655)+(1.086)+(5.008), (I-655)+(1.086)+(5.009), (I-655)+(1.086)+(5.010), (I-655)+(1.086)+(5.011), (I-655)+(1.086)+(5.012), (I-655)+(1.086)+(5.013), (I-655)+(1.086)+(5.014), (I-655)+(1.086)+(5.015), (I-655)+(1.086)+(5.016), (I-655)+(1.086)+(5.017), (I-655)+(1.086)+(5.018), (I-655)+(1.086)+(5.019), (I-655)+(1.086)+(5.020), (I-655)+(1.086)+(5.021), (I-655)+(1.086)+(5.022), (I-655)+(1.086)+(5.023), (I-655)+(1.086)+(6.001), (I-655)+(1.086)+(6.002), (I-655)+(1.086)+(6.003), (I-655)+(1.086)+(6.004), (I-655)+(1.086)+(7.001), (I-655)+(1.086)+(7.002), (I-655)+(1.086)+(7.003), (I-655)+(1.086)+(7.004), (I-655)+(1.086)+(7.005), (I-655)+(1.086)+(7.006), (I-655)+(1.086)+(9.001), (I-655)+(1.086)+(9.002), (I-655)+(1.086)+(9.003), (I-655)+(1.086)+(9.004), (I-655)+(1.086)+(9.005), (I-655)+(1.086)+(9.006), (I-655)+(1.086)+(9.007), (I-655)+(1.086)+(9.008), (I-655)+(1.086)+(9.009), (I-655)+(1.086)+(14.001), (I-655)+(1.086)+(14.002), (I-655)+(1.086)+(15.008), (I-655)+(1.086)+(15.011), (I-655)+(1.086)+(15.012), (I-655)+(1.086)+(15.016), (I-655)+(1.086)+(15.025), (I-655)+(1.086)+(15.027), (I-655)+(1.086)+(15.047), (I-655)+(1.086)+(15.063), (I-655)+(1.086)+(15.064), (I-655)+(1.086)+(16.001), (I-655)+(1.086)+(16.002), (I-655)+(1.086)+(16.003), (I-655)+(1.086)+(16.004), (I-655)+(1.086)+(16.005), (I-655)+(1.086)+(16.006), (I-655)+(1.086)+(16.007), (I-655)+(1.086)+(16.008), (I-655)+(1.086)+(17.001), (I-655)+(1.086)+(17.002), (I-655)+(1.086)+(17.003), (I-655)+(1.086)+(17.004), (I-655)+(1.086)+(17.005), (I-655)+(1.086)+(17.006), (I-655)+(1.086)+(17.007), (I-655)+(1.086)+(17.008), (I-655)+(1.086)+(17.009), (I-655)+(1.086)+(17.010), (I-655)+(1.086)+(17.011), (I-655)+(1.086)+(17.012), (I-655)+(1.086)+(18.001),

(I-655)+(1.087)+(1.088), (I-655)+(1.087)+(1.089), (I-655)+(1.087)+(1.090), (I-655)+(1.087)+(1.091), (I-655)+(1.087)+(1.092), (I-655)+(1.087)+(2.001), (I-655)+(1.087)+(2.002), (I-655)+(1.087)+(2.003), (I-655)+(1.087)+(2.004), (I-655)+(1.087)+(2.005), (I-655)+(1.087)+(2.006), (I-655)+(1.087)+(2.007), (I-655)+(1.087)+(2.008), (I-655)+(1.087)+(2.009), (I-655)+(1.087)+(2.010), (I-655)+(1.087)+(2.011), (I-655)+(1.087)+(2.012), (I-655)+(1.087)+(2.013), (I-655)+(1.087)+(2.014), (I-655)+(1.087)+(2.015), (I-655)+(1.087)+(2.016), (I-655)+(1.087)+(2.017), (I-655)+(1.087)+(2.018), (I-655)+(1.087)+(2.019), (I-655)+(1.087)+(2.020), (I-655)+(1.087)+(2.021), (I-655)+(1.087)+(2.022), (I-655)+(1.087)+(2.023), (I-655)+(1.087)+(2.024), (I-655)+(1.087)+(2.025), (I-655)+(1.087)+(2.026), (I-655)+(1.087)+(2.027), (I-655)+(1.087)+(2.028), (I-655)+(1.087)+(2.029), (I-655)+(1.087)+(2.030), (I-655)+(1.087)+(2.031), (I-655)+(1.087)+(2.032), (I-655)+(1.087)+(2.033), (I-655)+(1.087)+(2.034), (I-655)+(1.087)+(2.035), (I-655)+(1.087)+(2.036), (I-655)+(1.087)+(2.037), (I-655)+(1.087)+(2.038), (I-655)+(1.087)+(2.039), (I-655)+(1.087)+(2.040), (I-655)+(1.087)+(2.041), (I-655)+(1.087)+(2.042), (I-655)+(1.087)+(2.043), (I-655)+(1.087)+(2.044), (I-655)+(1.087)+(2.045), (I-655)+(1.087)+(2.046), (I-655)+(1.087)+(2.047), (I-655)+(1.087)+(2.048), (I-655)+(1.087)+(2.049), (I-655)+(1.087)+(2.050), (I-655)+(1.087)+(2.051), (I-655)+(1.087)+(2.052), (I-655)+(1.087)+(2.053), (I-655)+(1.087)+(2.054), (I-655)+(1.087)+(2.055), (I-655)+(1.087)+(2.056), (I-655)+(1.087)+(2.057), (I-655)+(1.087)+(2.058), (I-655)+(1.087)+(2.059), (I-655)+(1.087)+(3.001), (I-655)+(1.087)+(3.002), (I-655)+(1.087)+(3.003), (I-655)+(1.087)+(3.004), (I-655)+(1.087)+(3.005), (I-655)+(1.087)+(3.006), (I-655)+(1.087)+(3.007), (I-655)+(1.087)+(3.008), (I-655)+(1.087)+(3.009), (I-655)+(1.087)+(3.010), (I-655)+(1.087)+(3.011), (I-655)+(1.087)+(3.012), (I-655)+(1.087)+(3.013), (I-655)+(1.087)+(3.014), (I-655)+(1.087)+(3.015), (I-655)+(1.087)+(3.016), (I-655)+(1.087)+(3.017), (I-655)+(1.087)+(3.018), (I-655)+(1.087)+(3.019), (I-655)+(1.087)+(3.020), (I-655)+(1.087)+(3.021), (I-655)+(1.087)+(3.022), (I-655)+(1.087)+(3.023), (I-655)+(1.087)+(3.024), (I-655)+(1.087)+(3.025), (I-655)+(1.087)+(3.026), (I-655)+(1.087)+(3.027), (I-655)+(1.087)+(3.028), (I-655)+(1.087)+(3.029), (I-655)+(1.087)+(3.030), (I-655)+(1.087)+(3.031), (I-655)+(1.087)+(5.001), (I-655)+(1.087)+(5.002), (I-655)+(1.087)+(5.003), (I-655)+(1.087)+(5.004), (I-655)+(1.087)+(5.005), (I-655)+(1.087)+(5.006), (I-655)+(1.087)+(5.007), (I-655)+(1.087)+(5.008), (I-655)+(1.087)+(5.009), (I-655)+(1.087)+(5.010), (I-655)+(1.087)+(5.011), (I-655)+(1.087)+(5.012), (I-655)+(1.087)+(5.013), (I-655)+(1.087)+(5.014), (I-655)+(1.087)+(5.015), (I-655)+(1.087)+(5.016), (I-655)+(1.087)+(5.017), (I-655)+(1.087)+(5.018), (I-655)+(1.087)+(5.019), (I-655)+(1.087)+(5.020), (I-655)+(1.087)+(5.021), (I-655)+(1.087)+(5.022), (I-655)+(1.087)+(5.023), (I-655)+(1.087)+(6.001), (I-655)+(1.087)+(6.002), (I-655)+(1.087)+(6.003), (I-655)+(1.087)+(6.004), (I-655)+(1.087)+(7.001), (I-655)+(1.087)+(7.002), (I-655)+(1.087)+(7.003), (I-655)+(1.087)+(7.004), (I-655)+(1.087)+(7.005), (I-655)+(1.087)+(7.006), (I-655)+(1.087)+(9.001), (I-655)+(1.087)+(9.002), (I-655)+(1.087)+(9.003), (I-655)+(1.087)+(9.004), (I-655)+(1.087)+(9.005), (I-655)+(1.087)+(9.006), (I-655)+(1.087)+(9.007), (I-655)+(1.087)+(9.008), (I-655)+(1.087)+(9.009), (I-655)+(1.087)+(14.001), (I-655)+(1.087)+(14.002), (I-655)+(1.087)+(15.008), (I-655)+(1.087)+(15.011), (I-655)+(1.087)+(15.012), (I-655)+(1.087)+(15.016), (I-655)+(1.087)+(15.025), (I-655)+(1.087)+(15.027), (I-655)+(1.087)+(15.047), (I-655)+(1.087)+(15.063), (I-655)+(1.087)+(15.064), (I-655)+(1.087)+(16.001), (I-655)+(1.087)+(16.002), (I-655)+(1.087)+(16.003), (I-655)+(1.087)+(16.004), (I-655)+(1.087)+(16.005), (I-655)+(1.087)+(16.006), (I-655)+(1.087)+(16.007), (I-655)+(1.087)+(16.008), (I-655)+(1.087)+(17.001), (I-655)+(1.087)+(17.002), (I-655)+(1.087)+(17.003), (I-655)+(1.087)+(17.004), (I-655)+(1.087)+(17.005), (I-655)+(1.087)+(17.006), (I-655)+(1.087)+(17.007), (I-655)+(1.087)+(17.008), (I-655)+(1.087)+(17.009), (I-655)+(1.087)+(17.010), (I-655)+(1.087)+(17.011), (I-655)+(1.087)+(17.012), (I-655)+(1.087)+(18.001),

(I-655)+(1.088)+(1.089), (I-655)+(1.088)+(1.090), (I-655)+(1.088)+(1.091), (I-655)+(1.088)+(1.092), (I-655)+(1.088)+(2.001), (I-655)+(1.088)+(2.002), (I-655)+(1.088)+(2.003), (I-655)+(1.088)+(2.004), (I-655)+(1.088)+(2.005), (I-655)+(1.088)+(2.006), (I-655)+(1.088)+(2.007), (I-655)+(1.088)+(2.008), (I-655)+(1.088)+(2.009), (I-655)+(1.088)+(2.010), (I-655)+(1.088)+(2.011), (I-655)+(1.088)+(2.012), (I-655)+(1.088)+(2.013), (I-655)+(1.088)+(2.014), (I-655)+(1.088)+(2.015), (I-655)+(1.088)+(2.016), (I-655)+(1.088)+(2.017), (I-655)+(1.088)+(2.018), (I-655)+(1.088)+(2.019), (I-655)+(1.088)+(2.020), (I-655)+(1.088)+(2.021), (I-655)+(1.088)+(2.022), (I-655)+(1.088)+(2.023), (I-655)+(1.088)+(2.024), (I-655)+(1.088)+(2.025), (I-655)+(1.088)+(2.026), (I-655)+(1.088)+(2.027), (I-655)+(1.088)+(2.028), (I-655)+(1.088)+(2.029), (I-655)+(1.088)+(2.030), (I-655)+(1.088)+(2.031), (I-655)+(1.088)+(2.032), (I-655)+(1.088)+(2.033), (I-655)+(1.088)+(2.034), (I-655)+(1.088)+(2.035), (I-655)+(1.088)+(2.036), (I-655)+(1.088)+(2.037), (I-655)+(1.088)+(2.038), (I-655)+(1.088)+(2.039), (I-655)+(1.088)+(2.040), (I-655)+(1.088)+(2.041), (I-655)+(1.088)+(2.042), (I-655)+(1.088)+(2.043), (I-655)+(1.088)+(2.044), (I-655)+(1.088)+(2.045), (I-655)+(1.088)+(2.046), (I-655)+(1.088)+(2.047), (I-655)+(1.088)+(2.048), (I-655)+(1.088)+(2.049), (I-655)+(1.088)+(2.050), (I-655)+(1.088)+(2.051), (I-655)+(1.088)+(2.052), (I-655)+(1.088)+(2.053), (I-655)+(1.088)+(2.054), (I-655)+(1.088)+(2.055), (I-655)+(1.088)+(2.056), (I-655)+(1.088)+(2.057), (I-655)+(1.088)+(2.058), (I-655)+(1.088)+(2.059), (I-655)+(1.088)+(3.001), (I-655)+(1.088)+(3.002), (I-655)+(1.088)+(3.003), (I-655)+(1.088)+(3.004), (I-655)+(1.088)+(3.005), (I-655)+(1.088)+(3.006), (I-655)+(1.088)+(3.007), (I-655)+(1.088)+(3.008), (I-655)+(1.088)+(3.009), (I-655)+(1.088)+(3.010), (I-655)+(1.088)+(3.011), (I-655)+(1.088)+(3.012), (I-655)+(1.088)+(3.013), (I-655)+(1.088)+(3.014), (I-655)+(1.088)+(3.015), (I-655)+(1.088)+(3.016), (I-655)+(1.088)+(3.017), (I-655)+(1.088)+(3.018), (I-655)+(1.088)+(3.019), (I-655)+(1.088)+(3.020), (I-655)+(1.088)+(3.021), (I-655)+(1.088)+(3.022), (I-655)+(1.088)+(3.023), (I-655)+(1.088)+(3.024), (I-655)+(1.088)+(3.025), (I-655)+(1.088)+(3.026), (I-655)+(1.088)+(3.027), (I-655)+(1.088)+(3.028), (I-655)+(1.088)+(3.029), (I-655)+(1.088)+(3.030), (I-655)+(1.088)+(3.031), (I-655)+(1.088)+(5.001), (I-655)+(1.088)+(5.002), (I-655)+(1.088)+(5.003), (I-655)+(1.088)+(5.004), (I-655)+(1.088)+(5.005), (I-655)+(1.088)+(5.006), (I-655)+(1.088)+(5.007), (I-655)+(1.088)+(5.008), (I-655)+(1.088)+(5.009), (I-655)+(1.088)+(5.010), (I-655)+(1.088)+(5.011), (I-655)+(1.088)+(5.012), (I-655)+(1.088)+(5.013), (I-655)+(1.088)+(5.014), (I-655)+(1.088)+(5.015), (I-655)+(1.088)+(5.016), (I-655)+(1.088)+(5.017), (I-655)+(1.088)+(5.018), (I-655)+(1.088)+(5.019), (I-655)+(1.088)+(5.020), (I-655)+(1.088)+(5.021), (I-655)+(1.088)+(5.022), (I-655)+(1.088)+(5.023), (I-655)+(1.088)+(6.001), (I-655)+(1.088)+(6.002), (I-655)+(1.088)+(6.003), (I-655)+(1.088)+(6.004), (I-655)+(1.088)+(7.001), (I-655)+(1.088)+(7.002), (I-655)+(1.088)+(7.003), (I-655)+(1.088)+(7.004), (I-655)+(1.088)+(7.005), (I-655)+(1.088)+(7.006), (I-655)+(1.088)+(9.001), (I-655)+(1.088)+(9.002), (I-655)+(1.088)+(9.003), (I-655)+(1.088)+(9.004), (I-655)+(1.088)+(9.005), (I-655)+(1.088)+(9.006), (I-655)+(1.088)+(9.007), (I-655)+(1.088)+(9.008), (I-655)+(1.088)+(9.009), (I-655)+(1.088)+(14.001), (I-655)+(1.088)+(14.002), (I-655)+(1.088)+(15.008), (I-655)+(1.088)+(15.011), (I-655)+(1.088)+(15.012), (I-655)+(1.088)+(15.016), (I-655)+(1.088)+(15.025), (I-655)+(1.088)+(15.027), (I-655)+(1.088)+(15.047), (I-655)+(1.088)+(15.063), (I-655)+(1.088)+(15.064), (I-655)+(1.088)+(16.001), (I-655)+(1.088)+(16.002), (I-655)+(1.088)+(16.003), (I-655)+(1.088)+(16.004), (I-655)+(1.088)+(16.005), (I-655)+(1.088)+(16.006), (I-655)+(1.088)+(16.007), (I-655)+(1.088)+(16.008), (I-655)+(1.088)+(17.001), (I-655)+(1.088)+(17.002), (I-655)+(1.088)+(17.003), (I-655)+(1.088)+(17.004), (I-655)+(1.088)+(17.005), (I-655)+(1.088)+(17.006), (I-655)+(1.088)+(17.007), (I-655)+(1.088)+(17.008), (I-655)+(1.088)+(17.009), (I-655)+(1.088)+(17.010), (I-655)+(1.088)+(17.011), (I-655)+(1.088)+(17.012), (I-655)+(1.088)+(18.001),

(I-655)+(1.089)+(1.090), (I-655)+(1.089)+(1.091), (I-655)+(1.089)+(1.092), (I-655)+(1.089)+(2.001), (I-655)+(1.089)+(2.002), (I-655)+(1.089)+(2.003), (I-655)+(1.089)+(2.004), (I-655)+(1.089)+(2.005), (I-655)+(1.089)+(2.006), (I-655)+(1.089)+(2.007), (I-655)+(1.089)+(2.008), (I-655)+(1.089)+(2.009), (I-655)+(1.089)+(2.010), (I-655)+(1.089)+(2.011), (I-655)+(1.089)+(2.012), (I-655)+(1.089)+(2.013), (I-655)+(1.089)+(2.014), (I-655)+(1.089)+(2.015), (I-655)+(1.089)+(2.016), (I-655)+(1.089)+(2.017), (I-655)+(1.089)+(2.018), (I-655)+(1.089)+(2.019), (I-655)+(1.089)+(2.020), (I-655)+(1.089)+(2.021), (I-655)+(1.089)+(2.022), (I-655)+(1.089)+(2.023), (I-655)+(1.089)+(2.024), (I-655)+(1.089)+(2.025), (I-655)+(1.089)+(2.026), (I-655)+(1.089)+(2.027), (I-655)+(1.089)+(2.028), (I-655)+(1.089)+(2.029), (I-655)+(1.089)+(2.030), (I-655)+(1.089)+(2.031), (I-655)+(1.089)+(2.032), (I-655)+(1.089)+(2.033), (I-655)+(1.089)+(2.034), (I-655)+(1.089)+(2.035), (I-655)+(1.089)+(2.036), (I-655)+(1.089)+(2.037), (I-655)+(1.089)+(2.038), (I-655)+(1.089)+(2.039), (I-655)+(1.089)+(2.040), (I-655)+(1.089)+(2.041), (I-655)+(1.089)+(2.042), (I-655)+(1.089)+(2.043), (I-655)+(1.089)+(2.044), (I-655)+(1.089)+(2.045), (I-655)+(1.089)+(2.046), (I-655)+(1.089)+(2.047), (I-655)+(1.089)+(2.048), (I-655)+(1.089)+(2.049), (I-655)+(1.089)+(2.050), (I-655)+(1.089)+(2.051), (I-655)+(1.089)+(2.052), (I-655)+(1.089)+(2.053), (I-655)+(1.089)+(2.054), (I-655)+(1.089)+(2.055), (I-655)+(1.089)+(2.056), (I-655)+(1.089)+(2.057), (I-655)+(1.089)+(2.058), (I-655)+(1.089)+(2.059), (I-655)+(1.089)+(3.001), (I-655)+(1.089)+(3.002), (I-655)+(1.089)+(3.003), (I-655)+(1.089)+(3.004), (I-655)+(1.089)+(3.005), (I-655)+(1.089)+(3.006), (I-655)+(1.089)+(3.007), (I-655)+(1.089)+(3.008), (I-655)+(1.089)+(3.009), (I-655)+(1.089)+(3.010), (I-655)+(1.089)+(3.011), (I-655)+(1.089)+(3.012), (I-655)+(1.089)+(3.013), (I-655)+(1.089)+(3.014), (I-655)+(1.089)+(3.015), (I-655)+(1.089)+(3.016), (I-655)+(1.089)+(3.017), (I-655)+(1.089)+(3.018), (I-655)+(1.089)+(3.019), (I-655)+(1.089)+(3.020), (I-655)+(1.089)+(3.021), (I-655)+(1.089)+(3.022), (I-655)+(1.089)+(3.023), (I-655)+(1.089)+(3.024), (I-655)+(1.089)+(3.025), (I-655)+(1.089)+(3.026), (I-655)+(1.089)+(3.027), (I-655)+(1.089)+(3.028), (I-655)+(1.089)+(3.029), (I-655)+(1.089)+(3.030), (I-655)+(1.089)+(3.031), (I-655)+(1.089)+(5.001), (I-655)+(1.089)+(5.002), (I-655)+(1.089)+(5.003), (I-655)+(1.089)+(5.004), (I-655)+(1.089)+(5.005), (I-655)+(1.089)+(5.006), (I-655)+(1.089)+(5.007), (I-655)+(1.089)+(5.008), (I-655)+(1.089)+(5.009), (I-655)+(1.089)+(5.010), (I-655)+(1.089)+(5.011), (I-655)+(1.089)+(5.012), (I-655)+(1.089)+(5.013), (I-655)+(1.089)+(5.014), (I-655)+(1.089)+(5.015), (I-655)+(1.089)+(5.016), (I-655)+(1.089)+(5.017), (I-655)+(1.089)+(5.018), (I-655)+(1.089)+(5.019), (I-655)+(1.089)+(5.020), (I-655)+(1.089)+(5.021), (I-655)+(1.089)+(5.022), (I-655)+(1.089)+(5.023), (I-655)+(1.089)+(6.001), (I-655)+(1.089)+(6.002), (I-655)+(1.089)+(6.003), (I-655)+(1.089)+(6.004), (I-655)+(1.089)+(7.001), (I-655)+(1.089)+(7.002), (I-655)+(1.089)+(7.003), (I-655)+(1.089)+(7.004), (I-655)+(1.089)+(7.005), (I-655)+(1.089)+(7.006), (I-655)+(1.089)+(9.001), (I-655)+(1.089)+(9.002), (I-655)+(1.089)+(9.003), (I-655)+(1.089)+(9.004), (I-655)+(1.089)+(9.005), (I-655)+(1.089)+(9.006), (I-655)+(1.089)+(9.007), (I-655)+(1.089)+(9.008), (I-655)+(1.089)+(9.009), (I-655)+(1.089)+(14.001), (I-655)+(1.089)+(14.002), (I-655)+(1.089)+(15.008), (I-655)+(1.089)+(15.011), (I-655)+(1.089)+(15.012), (I-655)+(1.089)+(15.016), (I-655)+(1.089)+(15.025), (I-655)+(1.089)+(15.027), (I-655)+(1.089)+(15.047), (I-655)+(1.089)+(15.063), (I-655)+(1.089)+(15.064), (I-655)+(1.089)+(16.001), (I-655)+(1.089)+(16.002), (I-655)+(1.089)+(16.003), (I-655)+(1.089)+(16.004), (I-655)+(1.089)+(16.005), (I-655)+(1.089)+(16.006), (I-655)+(1.089)+(16.007), (I-655)+(1.089)+(16.008), (I-655)+(1.089)+(17.001), (I-655)+(1.089)+(17.002), (I-655)+(1.089)+(17.003), (I-655)+(1.089)+(17.004), (I-655)+(1.089)+(17.005), (I-655)+(1.089)+(17.006), (I-655)+(1.089)+(17.007), (I-655)+(1.089)+(17.008), (I-655)+(1.089)+(17.009), (I-655)+(1.089)+(17.010), (I-655)+(1.089)+(17.011), (I-655)+(1.089)+(17.012), (I-655)+(1.089)+(18.001),

(I-655)+(1.090)+(1.091), (I-655)+(1.090)+(1.092), (I-655)+(1.090)+(2.001), (I-655)+(1.090)+(2.002), (I-655)+(1.090)+(2.003), (I-655)+(1.090)+(2.004), (I-655)+(1.090)+(2.005), (I-655)+(1.090)+(2.006), (I-655)+(1.090)+(2.007), (I-655)+(1.090)+(2.008), (I-655)+(1.090)+(2.009), (I-655)+(1.090)+(2.010), (I-655)+(1.090)+(2.011), (I-655)+(1.090)+(2.012), (I-655)+(1.090)+(2.013), (I-655)+(1.090)+(2.014), (I-655)+(1.090)+(2.015), (I-655)+(1.090)+(2.016), (I-655)+(1.090)+(2.017), (I-655)+(1.090)+(2.018), (I-655)+(1.090)+(2.019), (I-655)+(1.090)+(2.020), (I-655)+(1.090)+(2.021), (I-655)+(1.090)+(2.022), (I-655)+(1.090)+(2.023), (I-655)+(1.090)+(2.024), (I-655)+(1.090)+(2.025), (I-655)+(1.090)+(2.026), (I-655)+(1.090)+(2.027), (I-655)+(1.090)+(2.028), (I-655)+(1.090)+(2.029), (I-655)+(1.090)+(2.030), (I-655)+(1.090)+(2.031), (I-655)+(1.090)+(2.032), (I-655)+(1.090)+(2.033), (I-655)+(1.090)+(2.034), (I-655)+(1.090)+(2.035), (I-655)+(1.090)+(2.036), (I-655)+(1.090)+(2.037), (I-655)+(1.090)+(2.038), (I-655)+(1.090)+(2.039), (I-655)+(1.090)+(2.040), (I-655)+(1.090)+(2.041), (I-655)+(1.090)+(2.042), (I-655)+(1.090)+(2.043), (I-655)+(1.090)+(2.044), (I-655)+(1.090)+(2.045), (I-655)+(1.090)+(2.046), (I-655)+(1.090)+(2.047), (I-655)+(1.090)+(2.048), (I-655)+(1.090)+(2.049), (I-655)+(1.090)+(2.050), (I-655)+(1.090)+(2.051), (I-655)+(1.090)+(2.052), (I-655)+(1.090)+(2.053), (I-655)+(1.090)+(2.054), (I-655)+(1.090)+(2.055), (I-655)+(1.090)+(2.056), (I-655)+(1.090)+(2.057), (I-655)+(1.090)+(2.058), (I-655)+(1.090)+(2.059), (I-655)+(1.090)+(3.001), (I-655)+(1.090)+(3.002), (I-655)+(1.090)+(3.003), (I-655)+(1.090)+(3.004), (I-655)+(1.090)+(3.005), (I-655)+(1.090)+(3.006), (I-655)+(1.090)+(3.007), (I-655)+(1.090)+(3.008), (I-655)+(1.090)+(3.009), (I-655)+(1.090)+(3.010), (I-655)+(1.090)+(3.011), (I-655)+(1.090)+(3.012), (I-655)+(1.090)+(3.013), (I-655)+(1.090)+(3.014), (I-655)+(1.090)+(3.015), (I-655)+(1.090)+(3.016), (I-655)+(1.090)+(3.017), (I-655)+(1.090)+(3.018), (I-655)+(1.090)+(3.019), (I-655)+(1.090)+(3.020), (I-655)+(1.090)+(3.021), (I-655)+(1.090)+(3.022), (I-655)+(1.090)+(3.023), (I-655)+(1.090)+(3.024), (I-655)+(1.090)+(3.025), (I-655)+(1.090)+(3.026), (I-655)+(1.090)+(3.027), (I-655)+(1.090)+(3.028), (I-655)+(1.090)+(3.029), (I-655)+(1.090)+(3.030), (I-655)+(1.090)+(3.031), (I-655)+(1.090)+(5.001), (I-655)+(1.090)+(5.002), (I-655)+(1.090)+(5.003), (I-655)+(1.090)+(5.004), (I-655)+(1.090)+(5.005), (I-655)+(1.090)+(5.006), (I-655)+(1.090)+(5.007), (I-655)+(1.090)+(5.008), (I-655)+(1.090)+(5.009), (I-655)+(1.090)+(5.010), (I-655)+(1.090)+(5.011), (I-655)+(1.090)+(5.012), (I-655)+(1.090)+(5.013), (I-655)+(1.090)+(5.014), (I-655)+(1.090)+(5.015), (I-655)+(1.090)+(5.016), (I-655)+(1.090)+(5.017), (I-655)+(1.090)+(5.018), (I-655)+(1.090)+(5.019), (I-655)+(1.090)+(5.020), (I-655)+(1.090)+(5.021), (I-655)+(1.090)+(5.022), (I-655)+(1.090)+(5.023), (I-655)+(1.090)+(6.001), (I-655)+(1.090)+(6.002), (I-655)+(1.090)+(6.003), (I-655)+(1.090)+(6.004), (I-655)+(1.090)+(7.001), (I-655)+(1.090)+(7.002), (I-655)+(1.090)+(7.003), (I-655)+(1.090)+(7.004), (I-655)+(1.090)+(7.005), (I-655)+(1.090)+(7.006), (I-655)+(1.090)+(9.001), (I-655)+(1.090)+(9.002), (I-655)+(1.090)+(9.003), (I-655)+(1.090)+(9.004), (I-655)+(1.090)+(9.005), (I-655)+(1.090)+(9.006), (I-655)+(1.090)+(9.007), (I-655)+(1.090)+(9.008), (I-655)+(1.090)+(9.009), (I-655)+(1.090)+(14.001), (I-655)+(1.090)+(14.002), (I-655)+(1.090)+(15.008), (I-655)+(1.090)+(15.011), (I-655)+(1.090)+(15.012), (I-655)+(1.090)+(15.016), (I-655)+(1.090)+(15.025), (I-655)+(1.090)+(15.027), (I-655)+(1.090)+(15.047), (I-655)+(1.090)+(15.063), (I-655)+(1.090)+(15.064), (I-655)+(1.090)+(16.001), (I-655)+(1.090)+(16.002), (I-655)+(1.090)+(16.003), (I-655)+(1.090)+(16.004), (I-655)+(1.090)+(16.005), (I-655)+(1.090)+(16.006), (I-655)+(1.090)+(16.007), (I-655)+(1.090)+(16.008), (I-655)+(1.090)+(17.001), (I-655)+(1.090)+(17.002), (I-655)+(1.090)+(17.003), (I-655)+(1.090)+(17.004), (I-655)+(1.090)+(17.005), (I-655)+(1.090)+(17.006), (I-655)+(1.090)+(17.007), (I-655)+(1.090)+(17.008), (I-655)+(1.090)+(17.009), (I-655)+(1.090)+(17.010), (I-655)+(1.090)+(17.011), (I-655)+(1.090)+(17.012), (I-655)+(1.090)+(18.001),

(I-655)+(1.091)+(1.092), (I-655)+(1.091)+(2.001), (I-655)+(1.091)+(2.002), (I-655)+(1.091)+(2.003), (I-655)+(1.091)+(2.004), (I-655)+(1.091)+(2.005), (I-655)+(1.091)+(2.006), (I-655)+(1.091)+(2.007), (I-655)+(1.091)+(2.008), (I-655)+(1.091)+(2.009), (I-655)+(1.091)+(2.010), (I-655)+(1.091)+(2.011), (I-655)+(1.091)+(2.012), (I-655)+(1.091)+(2.013), (I-655)+(1.091)+(2.014), (I-655)+(1.091)+(2.015), (I-655)+(1.091)+(2.016), (I-655)+(1.091)+(2.017), (I-655)+(1.091)+(2.018), (I-655)+(1.091)+(2.019), (I-655)+(1.091)+(2.020), (I-655)+(1.091)+(2.021), (I-655)+(1.091)+(2.022), (I-655)+(1.091)+(2.023), (I-655)+(1.091)+(2.024), (I-655)+(1.091)+(2.025), (I-655)+(1.091)+(2.026), (I-655)+(1.091)+(2.027), (I-655)+(1.091)+(2.028), (I-655)+(1.091)+(2.029), (I-655)+(1.091)+(2.030), (I-655)+(1.091)+(2.031), (I-655)+(1.091)+(2.032), (I-655)+(1.091)+(2.033), (I-655)+(1.091)+(2.034), (I-655)+(1.091)+(2.035), (I-655)+(1.091)+(2.036), (I-655)+(1.091)+(2.037), (I-655)+(1.091)+(2.038), (I-655)+(1.091)+(2.039), (I-655)+(1.091)+(2.040), (I-655)+(1.091)+(2.041), (I-655)+(1.091)+(2.042), (I-655)+(1.091)+(2.043), (I-655)+(1.091)+(2.044), (I-655)+(1.091)+(2.045), (I-655)+(1.091)+(2.046), (I-655)+(1.091)+(2.047), (I-655)+(1.091)+(2.048), (I-655)+(1.091)+(2.049), (I-655)+(1.091)+(2.050), (I-655)+(1.091)+(2.051), (I-655)+(1.091)+(2.052), (I-655)+(1.091)+(2.053), (I-655)+(1.091)+(2.054), (I-655)+(1.091)+(2.055), (I-655)+(1.091)+(2.056), (I-655)+(1.091)+(2.057), (I-655)+(1.091)+(2.058), (I-655)+(1.091)+(2.059), (I-655)+(1.091)+(3.001), (I-655)+(1.091)+(3.002), (I-655)+(1.091)+(3.003), (I-655)+(1.091)+(3.004), (I-655)+(1.091)+(3.005), (I-655)+(1.091)+(3.006), (I-655)+(1.091)+(3.007), (I-655)+(1.091)+(3.008), (I-655)+(1.091)+(3.009), (I-655)+(1.091)+(3.010), (I-655)+(1.091)+(3.011), (I-655)+(1.091)+(3.012), (I-655)+(1.091)+(3.013), (I-655)+(1.091)+(3.014), (I-655)+(1.091)+(3.015), (I-655)+(1.091)+(3.016), (I-655)+(1.091)+(3.017), (I-655)+(1.091)+(3.018), (I-655)+(1.091)+(3.019), (I-655)+(1.091)+(3.020), (I-655)+(1.091)+(3.021), (I-655)+(1.091)+(3.022), (I-655)+(1.091)+(3.023), (I-655)+(1.091)+(3.024), (I-655)+(1.091)+(3.025), (I-655)+(1.091)+(3.026), (I-655)+(1.091)+(3.027), (I-655)+(1.091)+(3.028), (I-655)+(1.091)+(3.029), (I-655)+(1.091)+(3.030), (I-655)+(1.091)+(3.031), (I-655)+(1.091)+(5.001), (I-655)+(1.091)+(5.002), (I-655)+(1.091)+(5.003), (I-655)+(1.091)+(5.004), (I-655)+(1.091)+(5.005), (I-655)+(1.091)+(5.006), (I-655)+(1.091)+(5.007), (I-655)+(1.091)+(5.008), (I-655)+(1.091)+(5.009), (I-655)+(1.091)+(5.010), (I-655)+(1.091)+(5.011), (I-655)+(1.091)+(5.012), (I-655)+(1.091)+(5.013), (I-655)+(1.091)+(5.014), (I-655)+(1.091)+(5.015), (I-655)+(1.091)+(5.016), (I-655)+(1.091)+(5.017), (I-655)+(1.091)+(5.018), (I-655)+(1.091)+(5.019), (I-655)+(1.091)+(5.020), (I-655)+(1.091)+(5.021), (I-655)+(1.091)+(5.022), (I-655)+(1.091)+(5.023), (I-655)+(1.091)+(6.001), (I-655)+(1.091)+(6.002), (I-655)+(1.091)+(6.003), (I-655)+(1.091)+(6.004), (I-655)+(1.091)+(7.001), (I-655)+(1.091)+(7.002), (I-655)+(1.091)+(7.003), (I-655)+(1.091)+(7.004), (I-655)+(1.091)+(7.005), (I-655)+(1.091)+(7.006), (I-655)+(1.091)+(9.001), (I-655)+(1.091)+(9.002), (I-655)+(1.091)+(9.003), (I-655)+(1.091)+(9.004), (I-655)+(1.091)+(9.005), (I-655)+(1.091)+(9.006), (I-655)+(1.091)+(9.007), (I-655)+(1.091)+(9.008), (I-655)+(1.091)+(9.009), (I-655)+(1.091)+(14.001), (I-655)+(1.091)+(14.002), (I-655)+(1.091)+(15.008), (I-655)+(1.091)+(15.011), (I-655)+(1.091)+(15.012), (I-655)+(1.091)+(15.016), (I-655)+(1.091)+(15.025), (I-655)+(1.091)+(15.027), (I-655)+(1.091)+(15.047), (I-655)+(1.091)+(15.063), (I-655)+(1.091)+(15.064), (I-655)+(1.091)+(16.001), (I-655)+(1.091)+(16.002), (I-655)+(1.091)+(16.003), (I-655)+(1.091)+(16.004), (I-655)+(1.091)+(16.005), (I-655)+(1.091)+(16.006), (I-655)+(1.091)+(16.007), (I-655)+(1.091)+(16.008), (I-655)+(1.091)+(17.001), (I-655)+(1.091)+(17.002), (I-655)+(1.091)+(17.003), (I-655)+(1.091)+(17.004), (I-655)+(1.091)+(17.005), (I-655)+(1.091)+(17.006), (I-655)+(1.091)+(17.007), (I-655)+(1.091)+(17.008), (I-655)+(1.091)+(17.009), (I-655)+(1.091)+(17.010), (I-655)+(1.091)+(17.011), (I-655)+(1.091)+(17.012), (I-655)+(1.091)+(18.001),

(I-655)+(1.092)+(2.001), (I-655)+(1.092)+(2.002), (I-655)+(1.092)+(2.003), (I-655)+(1.092)+(2.004), (I-655)+(1.092)+(2.005), (I-655)+(1.092)+(2.006), (I-655)+(1.092)+(2.007), (I-655)+(1.092)+(2.008), (I-655)+(1.092)+(2.009), (I-655)+(1.092)+(2.010), (I-655)+(1.092)+(2.011), (I-655)+(1.092)+(2.012), (I-655)+(1.092)+(2.013), (I-655)+(1.092)+(2.014), (I-655)+(1.092)+(2.015), (I-655)+(1.092)+(2.016), (I-655)+(1.092)+(2.017), (I-655)+(1.092)+(2.018), (I-655)+(1.092)+(2.019), (I-655)+(1.092)+(2.020), (I-655)+(1.092)+(2.021), (I-655)+(1.092)+(2.022), (I-655)+(1.092)+(2.023), (I-655)+(1.092)+(2.024), (I-655)+(1.092)+(2.025), (I-655)+(1.092)+(2.026), (I-655)+(1.092)+(2.027), (I-655)+(1.092)+(2.028), (I-655)+(1.092)+(2.029), (I-655)+(1.092)+(2.030), (I-655)+(1.092)+(2.031), (I-655)+(1.092)+(2.032), (I-655)+(1.092)+(2.033), (I-655)+(1.092)+(2.034), (I-655)+(1.092)+(2.035), (I-655)+(1.092)+(2.036), (I-655)+(1.092)+(2.037), (I-655)+(1.092)+(2.038), (I-655)+(1.092)+(2.039), (I-655)+(1.092)+(2.040), (I-655)+(1.092)+(2.041), (I-655)+(1.092)+(2.042), (I-655)+(1.092)+(2.043), (I-655)+(1.092)+(2.044), (I-655)+(1.092)+(2.045), (I-655)+(1.092)+(2.046), (I-655)+(1.092)+(2.047), (I-655)+(1.092)+(2.048), (I-655)+(1.092)+(2.049), (I-655)+(1.092)+(2.050), (I-655)+(1.092)+(2.051), (I-655)+(1.092)+(2.052), (I-655)+(1.092)+(2.053), (I-655)+(1.092)+(2.054), (I-655)+(1.092)+(2.055), (I-655)+(1.092)+(2.056), (I-655)+(1.092)+(2.057), (I-655)+(1.092)+(2.058), (I-655)+(1.092)+(2.059), (I-655)+(1.092)+(3.001), (I-655)+(1.092)+(3.002), (I-655)+(1.092)+(3.003), (I-655)+(1.092)+(3.004), (I-655)+(1.092)+(3.005), (I-655)+(1.092)+(3.006), (I-655)+(1.092)+(3.007), (I-655)+(1.092)+(3.008), (I-655)+(1.092)+(3.009), (I-655)+(1.092)+(3.010), (I-655)+(1.092)+(3.011), (I-655)+(1.092)+(3.012), (I-655)+(1.092)+(3.013), (I-655)+(1.092)+(3.014), (I-655)+(1.092)+(3.015), (I-655)+(1.092)+(3.016), (I-655)+(1.092)+(3.017), (I-655)+(1.092)+(3.018), (I-655)+(1.092)+(3.019), (I-655)+(1.092)+(3.020), (I-655)+(1.092)+(3.021), (I-655)+(1.092)+(3.022), (I-655)+(1.092)+(3.023), (I-655)+(1.092)+(3.024), (I-655)+(1.092)+(3.025), (I-655)+(1.092)+(3.026), (I-655)+(1.092)+(3.027), (I-655)+(1.092)+(3.028), (I-655)+(1.092)+(3.029), (I-655)+(1.092)+(3.030), (I-655)+(1.092)+(3.031), (I-655)+(1.092)+(5.001), (I-655)+(1.092)+(5.002), (I-655)+(1.092)+(5.003), (I-655)+(1.092)+(5.004), (I-655)+(1.092)+(5.005), (I-655)+(1.092)+(5.006), (I-655)+(1.092)+(5.007), (I-655)+(1.092)+(5.008), (I-655)+(1.092)+(5.009), (I-655)+(1.092)+(5.010), (I-655)+(1.092)+(5.011), (I-655)+(1.092)+(5.012), (I-655)+(1.092)+(5.013), (I-655)+(1.092)+(5.014), (I-655)+(1.092)+(5.015), (I-655)+(1.092)+(5.016), (I-655)+(1.092)+(5.017), (I-655)+(1.092)+(5.018), (I-655)+(1.092)+(5.019), (I-655)+(1.092)+(5.020), (I-655)+(1.092)+(5.021), (I-655)+(1.092)+(5.022), (I-655)+(1.092)+(5.023), (I-655)+(1.092)+(6.001), (I-655)+(1.092)+(6.002), (I-655)+(1.092)+(6.003), (I-655)+(1.092)+(6.004), (I-655)+(1.092)+(7.001), (I-655)+(1.092)+(7.002), (I-655)+(1.092)+(7.003), (I-655)+(1.092)+(7.004), (I-655)+(1.092)+(7.005), (I-655)+(1.092)+(7.006), (I-655)+(1.092)+(9.001), (I-655)+(1.092)+(9.002), (I-655)+(1.092)+(9.003), (I-655)+(1.092)+(9.004), (I-655)+(1.092)+(9.005), (I-655)+(1.092)+(9.006), (I-655)+(1.092)+(9.007), (I-655)+(1.092)+(9.008), (I-655)+(1.092)+(9.009), (I-655)+(1.092)+(14.001), (I-655)+(1.092)+(14.002), (I-655)+(1.092)+(15.008), (I-655)+(1.092)+(15.011), (I-655)+(1.092)+(15.012), (I-655)+(1.092)+(15.016), (I-655)+(1.092)+(15.025), (I-655)+(1.092)+(15.027), (I-655)+(1.092)+(15.047), (I-655)+(1.092)+(15.063), (I-655)+(1.092)+(15.064), (I-655)+(1.092)+(16.001), (I-655)+(1.092)+(16.002), (I-655)+(1.092)+(16.003), (I-655)+(1.092)+(16.004), (I-655)+(1.092)+(16.005), (I-655)+(1.092)+(16.006), (I-655)+(1.092)+(16.007), (I-655)+(1.092)+(16.008), (I-655)+(1.092)+(17.001), (I-655)+(1.092)+(17.002), (I-655)+(1.092)+(17.003), (I-655)+(1.092)+(17.004), (I-655)+(1.092)+(17.005), (I-655)+(1.092)+(17.006), (I-655)+(1.092)+(17.007), (I-655)+(1.092)+(17.008), (I-655)+(1.092)+(17.009), (I-655)+(1.092)+(17.010), (I-655)+(1.092)+(17.011), (I-655)+(1.092)+(17.012), (I-655)+(1.092)+(18.001), (I-655)+(2.001)+(3.001), (I-655)+(2.001)+(3.002), (I-655)+(2.001)+(3.003), (I-655)+(2.001)+(3.004), (I-655)+(2.001)+(3.005), (I-655)+(2.001)+(3.006), (I-655)+(2.001)+(3.007), (I-655)+(2.001)+(3.008), (I-655)+(2.001)+(3.009), (I-655)+(2.001)+(3.010), (I-655)+(2.001)+(3.011), (I-655)+(2.001)+(3.012), (I-655)+(2.001)+(3.013), (I-655)+(2.001)+(3.014), (I-655)+(2.001)+(3.015), (I-655)+(2.001)+(3.016), (I-655)+(2.001)+(3.017), (I-655)+(2.001)+(3.018), (I-655)+(2.001)+(3.019), (I-655)+(2.001)+(3.020), (I-655)+(2.001)+(3.021), (I-655)+(2.001)+(3.022), (I-655)+(2.001)+(3.023), (I-655)+(2.001)+(3.024), (I-655)+(2.001)+(3.025), (I-655)+(2.001)+(3.026), (I-655)+(2.001)+(3.027), (I-655)+(2.001)+(3.028), (I-655)+(2.001)+(3.029), (I-655)+(2.001)+(3.030), (I-655)+(2.001)+(3.031), (I-655)+(2.001)+(5.001), (I-655)+(2.001)+(5.002), (I-655)+(2.001)+(5.003), (I-655)+(2.001)+(5.004), (I-655)+(2.001)+(5.005), (I-655)+(2.001)+(5.006), (I-655)+(2.001)+(5.007), (I-655)+(2.001)+(5.008), (I-655)+(2.001)+(5.009), (I-655)+(2.001)+(5.010), (I-655)+(2.001)+(5.011), (I-655)+(2.001)+(5.012), (I-655)+(2.001)+(5.013), (I-655)+(2.001)+(5.014), (I-655)+(2.001)+(5.015), (I-655)+(2.001)+(5.016), (I-655)+(2.001)+(5.017), (I-655)+(2.001)+(5.018), (I-655)+(2.001)+(5.019), (I-655)+(2.001)+(5.020), (I-655)+(2.001)+(5.021), (I-655)+(2.001)+(5.022), (I-655)+(2.001)+(5.023), (I-655)+(2.001)+(6.001), (I-655)+(2.001)+(6.002), (I-655)+(2.001)+(6.003), (I-655)+(2.001)+(6.004), (I-655)+(2.001)+(7.001), (I-655)+(2.001)+(7.002), (I-655)+(2.001)+(7.003), (I-655)+(2.001)+(7.004), (I-655)+(2.001)+(7.005), (I-655)+(2.001)+(7.006), (I-655)+(2.001)+(9.001), (I-655)+(2.001)+(9.002), (I-655)+(2.001)+(9.003), (I-655)+(2.001)+(9.004), (I-655)+(2.001)+(9.005), (I-655)+(2.001)+(9.006), (I-655)+(2.001)+(9.007), (I-655)+(2.001)+(9.008), (I-655)+(2.001)+(9.009), (I-655)+(2.001)+(14.001), (I-655)+(2.001)+(14.002), (I-655)+(2.001)+(15.008), (I-655)+(2.001)+(15.011), (I-655)+(2.001)+(15.012), (I-655)+(2.001)+(15.016), (I-655)+(2.001)+(15.025), (I-655)+(2.001)+(15.027), (I-655)+(2.001)+(15.047), (I-655)+(2.001)+(15.063), (I-655)+(2.001)+(15.064), (I-655)+(2.001)+(16.001), (I-655)+(2.001)+(16.002), (I-655)+(2.001)+(16.003), (I-655)+(2.001)+(16.004), (I-655)+(2.001)+(16.005), (I-655)+(2.001)+(16.006), (I-655)+(2.001)+(16.007), (I-655)+(2.001)+(16.008), (I-655)+(2.001)+(17.001), (I-655)+(2.001)+(17.002), (I-655)+(2.001)+(17.003), (I-655)+(2.001)+(17.004), (I-655)+(2.001)+(17.005), (I-655)+(2.001)+(17.006), (I-655)+(2.001)+(17.007), (I-655)+(2.001)+(17.008), (I-655)+(2.001)+(17.009), (I-655)+(2.001)+(17.010), (I-655)+(2.001)+(17.011), (I-655)+(2.001)+(17.012), (I-655)+(2.001)+(18.001),

(I-655)+(2.002)+(3.001), (I-655)+(2.002)+(3.002), (I-655)+(2.002)+(3.003), (I-655)+(2.002)+(3.004), (I-655)+(2.002)+(3.005), (I-655)+(2.002)+(3.006), (I-655)+(2.002)+(3.007), (I-655)+(2.002)+(3.008), (I-655)+(2.002)+(3.009), (I-655)+(2.002)+(3.010), (I-655)+(2.002)+(3.011), (I-655)+(2.002)+(3.012), (I-655)+(2.002)+(3.013), (I-655)+(2.002)+(3.014), (I-655)+(2.002)+(3.015), (I-655)+(2.002)+(3.016), (I-655)+(2.002)+(3.017), (I-655)+(2.002)+(3.018), (I-655)+(2.002)+(3.019), (I-655)+(2.002)+(3.020), (I-655)+(2.002)+(3.021), (I-655)+(2.002)+(3.022), (I-655)+(2.002)+(3.023), (I-655)+(2.002)+(3.024), (I-655)+(2.002)+(3.025), (I-655)+(2.002)+(3.026), (I-655)+(2.002)+(3.027), (I-655)+(2.002)+(3.028), (I-655)+(2.002)+(3.029), (I-655)+(2.002)+(3.030), (I-655)+(2.002)+(3.031), (I-655)+(2.002)+(5.001), (I-655)+(2.002)+(5.002), (I-655)+(2.002)+(5.003), (I-655)+(2.002)+(5.004), (I-655)+(2.002)+(5.005), (I-655)+(2.002)+(5.006), (I-655)+(2.002)+(5.007), (I-655)+(2.002)+(5.008), (I-655)+(2.002)+(5.009), (I-655)+(2.002)+(5.010), (I-655)+(2.002)+(5.011), (I-655)+(2.002)+(5.012), (I-655)+(2.002)+(5.013), (I-655)+(2.002)+(5.014), (I-655)+(2.002)+(5.015), (I-655)+(2.002)+(5.016), (I-655)+(2.002)+(5.017), (I-655)+(2.002)+(5.018), (I-655)+(2.002)+(5.019), (I-655)+(2.002)+(5.020), (I-655)+(2.002)+(5.021), (I-655)+(2.002)+(5.022), (I-655)+(2.002)+(5.023), (I-655)+(2.002)+(6.001), (I-655)+(2.002)+(6.002), (I-655)+(2.002)+(6.003), (I-655)+(2.002)+(6.004), (I-655)+(2.002)+(7.001), (I-655)+(2.002)+(7.002), (I-655)+(2.002)+(7.003), (I-655)+(2.002)+(7.004), (I-655)+(2.002)+(7.005), (I-655)+(2.002)+(7.006), (I-655)+(2.002)+(9.001), (I-655)+(2.002)+(9.002), (I-655)+(2.002)+(9.003), (I-655)+(2.002)+(9.004), (I-655)+(2.002)+(9.005), (I-655)+(2.002)+(9.006), (I-655)+(2.002)+(9.007), (I-655)+(2.002)+(9.008), (I-655)+(2.002)+(9.009), (I-655)+(2.002)+(14.001), (I-655)+(2.002)+(14.002), (I-655)+(2.002)+(15.008), (I-655)+(2.002)+(15.011), (I-655)+(2.002)+(15.012), (I-655)+(2.002)+(15.016), (I-655)+(2.002)+(15.025), (I-655)+(2.002)+(15.027), (I-655)+(2.002)+(15.047), (I-655)+(2.002)+(15.063), (I-655)+(2.002)+(15.064), (I-655)+(2.002)+(16.001), (I-655)+(2.002)+(16.002), (I-655)+(2.002)+(16.003), (I-655)+(2.002)+(16.004), (I-655)+(2.002)+(16.005), (I-655)+(2.002)+(16.006), (I-655)+(2.002)+(16.007), (I-655)+(2.002)+(16.008), (I-655)+(2.002)+(17.001), (I-655)+(2.002)+(17.002), (I-655)+(2.002)+(17.003), (I-655)+(2.002)+(17.004), (I-655)+(2.002)+(17.005), (I-655)+(2.002)+(17.006), (I-655)+(2.002)+(17.007), (I-655)+(2.002)+(17.008), (I-655)+(2.002)+(17.009), (I-655)+(2.002)+(17.010), (I-655)+(2.002)+(17.011), (I-655)+(2.002)+(17.012), (I-655)+(2.002)+(18.001),

(I-655)+(2.003)+(3.001), (I-655)+(2.003)+(3.002), (I-655)+(2.003)+(3.003), (I-655)+(2.003)+(3.004), (I-655)+(2.003)+(3.005), (I-655)+(2.003)+(3.006), (I-655)+(2.003)+(3.007), (I-655)+(2.003)+(3.008), (I-655)+(2.003)+(3.009), (I-655)+(2.003)+(3.010), (I-655)+(2.003)+(3.011), (I-655)+(2.003)+(3.012), (I-655)+(2.003)+(3.013), (I-655)+(2.003)+(3.014), (I-655)+(2.003)+(3.015), (I-655)+(2.003)+(3.016), (I-655)+(2.003)+(3.017), (I-655)+(2.003)+(3.018), (I-655)+(2.003)+(3.019), (I-655)+(2.003)+(3.020), (I-655)+(2.003)+(3.021), (I-655)+(2.003)+(3.022), (I-655)+(2.003)+(3.023), (I-655)+(2.003)+(3.024), (I-655)+(2.003)+(3.025), (I-655)+(2.003)+(3.026), (I-655)+(2.003)+(3.027), (I-655)+(2.003)+(3.028), (I-655)+(2.003)+(3.029), (I-655)+(2.003)+(3.030), (I-655)+(2.003)+(3.031), (I-655)+(2.003)+(5.001), (I-655)+(2.003)+(5.002), (I-655)+(2.003)+(5.003), (I-655)+(2.003)+(5.004), (I-655)+(2.003)+(5.005), (I-655)+(2.003)+(5.006), (I-655)+(2.003)+(5.007), (I-655)+(2.003)+(5.008), (I-655)+(2.003)+(5.009), (I-655)+(2.003)+(5.010), (I-655)+(2.003)+(5.011), (I-655)+(2.003)+(5.012), (I-655)+(2.003)+(5.013), (I-655)+(2.003)+(5.014), (I-655)+(2.003)+(5.015), (I-655)+(2.003)+(5.016), (I-655)+(2.003)+(5.017), (I-655)+(2.003)+(5.018), (I-655)+(2.003)+(5.019), (I-655)+(2.003)+(5.020), (I-655)+(2.003)+(5.021), (I-655)+(2.003)+(5.022), (I-655)+(2.003)+(5.023), (I-655)+(2.003)+(6.001), (I-655)+(2.003)+(6.002), (I-655)+(2.003)+(6.003), (I-655)+(2.003)+(6.004), (I-655)+(2.003)+(7.001), (I-655)+(2.003)+(7.002), (I-655)+(2.003)+(7.003), (I-655)+(2.003)+(7.004), (I-655)+(2.003)+(7.005), (I-655)+(2.003)+(7.006), (I-655)+(2.003)+(9.001), (I-655)+(2.003)+(9.002), (I-655)+(2.003)+(9.003), (I-655)+(2.003)+(9.004), (I-655)+(2.003)+(9.005), (I-655)+(2.003)+(9.006), (I-655)+(2.003)+(9.007), (I-655)+(2.003)+(9.008), (I-655)+(2.003)+(9.009), (I-655)+(2.003)+(14.001), (I-655)+(2.003)+(14.002), (I-655)+(2.003)+(15.008), (I-655)+(2.003)+(15.011), (I-655)+(2.003)+(15.012), (I-655)+(2.003)+(15.016), (I-655)+(2.003)+(15.025), (I-655)+(2.003)+(15.027), (I-655)+(2.003)+(15.047), (I-655)+(2.003)+(15.063), (I-655)+(2.003)+(15.064), (I-655)+(2.003)+(16.001), (I-655)+(2.003)+(16.002), (I-655)+(2.003)+(16.003), (I-655)+(2.003)+(16.004), (I-655)+(2.003)+(16.005), (I-655)+(2.003)+(16.006), (I-655)+(2.003)+(16.007), (I-655)+(2.003)+(16.008), (I-655)+(2.003)+(17.001), (I-655)+(2.003)+(17.002), (I-655)+(2.003)+(17.003), (I-655)+(2.003)+(17.004), (I-655)+(2.003)+(17.005), (I-655)+(2.003)+(17.006), (I-655)+(2.003)+(17.007), (I-655)+(2.003)+(17.008), (I-655)+(2.003)+(17.009), (I-655)+(2.003)+(17.010), (I-655)+(2.003)+(17.011), (I-655)+(2.003)+(17.012), (I-655)+(2.003)+(18.001),

(I-655)+(2.004)+(3.001), (I-655)+(2.004)+(3.002), (I-655)+(2.004)+(3.003), (I-655)+(2.004)+(3.004), (I-655)+(2.004)+(3.005), (I-655)+(2.004)+(3.006), (I-655)+(2.004)+(3.007), (I-655)+(2.004)+(3.008), (I-655)+(2.004)+(3.009), (I-655)+(2.004)+(3.010), (I-655)+(2.004)+(3.011), (I-655)+(2.004)+(3.012), (I-655)+(2.004)+(3.013), (I-655)+(2.004)+(3.014), (I-655)+(2.004)+(3.015), (I-655)+(2.004)+(3.016), (I-655)+(2.004)+(3.017), (I-655)+(2.004)+(3.018), (I-655)+(2.004)+(3.019), (I-655)+(2.004)+(3.020), (I-655)+(2.004)+(3.021), (I-655)+(2.004)+(3.022), (I-655)+(2.004)+(3.023), (I-655)+(2.004)+(3.024), (I-655)+(2.004)+(3.025), (I-655)+(2.004)+(3.026), (I-655)+(2.004)+(3.027), (I-655)+(2.004)+(3.028), (I-655)+(2.004)+(3.029), (I-655)+(2.004)+(3.030), (I-655)+(2.004)+(3.031), (I-655)+(2.004)+(5.001), (I-655)+(2.004)+(5.002), (I-655)+(2.004)+(5.003), (I-655)+(2.004)+(5.004), (I-655)+(2.004)+(5.005), (I-655)+(2.004)+(5.006), (I-655)+(2.004)+(5.007), (I-655)+(2.004)+(5.008), (I-655)+(2.004)+(5.009), (I-655)+(2.004)+(5.010), (I-655)+(2.004)+(5.011), (I-655)+(2.004)+(5.012), (I-655)+(2.004)+(5.013), (I-655)+(2.004)+(5.014), (I-655)+(2.004)+(5.015), (I-655)+(2.004)+(5.016), (I-655)+(2.004)+(5.017), (I-655)+(2.004)+(5.018), (I-655)+(2.004)+(5.019), (I-655)+(2.004)+(5.020), (I-655)+(2.004)+(5.021), (I-655)+(2.004)+(5.022), (I-655)+(2.004)+(5.023), (I-655)+(2.004)+(6.001), (I-655)+(2.004)+(6.002), (I-655)+(2.004)+(6.003), (I-655)+(2.004)+(6.004), (I-655)+(2.004)+(7.001), (I-655)+(2.004)+(7.002), (I-655)+(2.004)+(7.003), (I-655)+(2.004)+(7.004), (I-655)+(2.004)+(7.005), (I-655)+(2.004)+(7.006), (I-655)+(2.004)+(9.001), (I-655)+(2.004)+(9.002), (I-655)+(2.004)+(9.003), (I-655)+(2.004)+(9.004), (I-655)+(2.004)+(9.005), (I-655)+(2.004)+(9.006), (I-655)+(2.004)+(9.007), (I-655)+(2.004)+(9.008), (I-655)+(2.004)+(9.009), (I-655)+(2.004)+(14.001), (I-655)+(2.004)+(14.002), (I-655)+(2.004)+(15.008), (I-655)+(2.004)+(15.011), (I-655)+(2.004)+(15.012), (I-655)+(2.004)+(15.016), (I-655)+(2.004)+(15.025), (I-655)+(2.004)+(15.027), (I-655)+(2.004)+(15.047), (I-655)+(2.004)+(15.063), (I-655)+(2.004)+(15.064), (I-655)+(2.004)+(16.001), (I-655)+(2.004)+(16.002), (I-655)+(2.004)+(16.003), (I-655)+(2.004)+(16.004), (I-655)+(2.004)+(16.005), (I-655)+(2.004)+(16.006), (I-655)+(2.004)+(16.007), (I-655)+(2.004)+(16.008), (I-655)+(2.004)+(17.001), (I-655)+(2.004)+(17.002), (I-655)+(2.004)+(17.003), (I-655)+(2.004)+(17.004), (I-655)+(2.004)+(17.005), (I-655)+(2.004)+(17.006), (I-655)+(2.004)+(17.007), (I-655)+(2.004)+(17.008), (I-655)+(2.004)+(17.009), (I-655)+(2.004)+(17.010), (I-655)+(2.004)+(17.011), (I-655)+(2.004)+(17.012), (I-655)+(2.004)+(18.001),

(I-655)+(2.005)+(3.001), (I-655)+(2.005)+(3.002), (I-655)+(2.005)+(3.003), (I-655)+(2.005)+(3.004), (I-655)+(2.005)+(3.005), (I-655)+(2.005)+(3.006), (I-655)+(2.005)+(3.007), (I-655)+(2.005)+(3.008), (I-655)+(2.005)+(3.009), (I-655)+(2.005)+(3.010), (I-655)+(2.005)+(3.011), (I-655)+(2.005)+(3.012), (I-655)+(2.005)+(3.013), (I-655)+(2.005)+(3.014), (I-655)+(2.005)+(3.015), (I-655)+(2.005)+(3.016), (I-655)+(2.005)+(3.017), (I-655)+(2.005)+(3.018), (I-655)+(2.005)+(3.019), (I-655)+(2.005)+(3.020), (I-655)+(2.005)+(3.021), (I-655)+(2.005)+(3.022), (I-655)+(2.005)+(3.023), (I-655)+(2.005)+(3.024), (I-655)+(2.005)+(3.025), (I-655)+(2.005)+(3.026), (I-655)+(2.005)+(3.027), (I-655)+(2.005)+(3.028), (I-655)+(2.005)+(3.029), (I-655)+(2.005)+(3.030), (I-655)+(2.005)+(3.031), (I-655)+(2.005)+(5.001), (I-655)+(2.005)+(5.002), (I-655)+(2.005)+(5.003), (I-655)+(2.005)+(5.004), (I-655)+(2.005)+(5.005), (I-655)+(2.005)+(5.006), (I-655)+(2.005)+(5.007), (I-655)+(2.005)+(5.008), (I-655)+(2.005)+(5.009), (I-655)+(2.005)+(5.010), (I-655)+(2.005)+(5.011), (I-655)+(2.005)+(5.012), (I-655)+(2.005)+(5.013), (I-655)+(2.005)+(5.014), (I-655)+(2.005)+(5.015), (I-655)+(2.005)+(5.016), (I-655)+(2.005)+(5.017), (I-655)+(2.005)+(5.018), (I-655)+(2.005)+(5.019), (I-655)+(2.005)+(5.020), (I-655)+(2.005)+(5.021), (I-655)+(2.005)+(5.022), (I-655)+(2.005)+(5.023), (I-655)+(2.005)+(6.001), (I-655)+(2.005)+(6.002), (I-655)+(2.005)+(6.003), (I-655)+(2.005)+(6.004), (I-655)+(2.005)+(7.001), (I-655)+(2.005)+(7.002), (I-655)+(2.005)+(7.003), (I-655)+(2.005)+(7.004), (I-655)+(2.005)+(7.005), (I-655)+(2.005)+(7.006), (I-655)+(2.005)+(9.001), (I-655)+(2.005)+(9.002), (I-655)+(2.005)+(9.003), (I-655)+(2.005)+(9.004), (I-655)+(2.005)+(9.005), (I-655)+(2.005)+(9.006), (I-655)+(2.005)+(9.007), (I-655)+(2.005)+(9.008), (I-655)+(2.005)+(9.009), (I-655)+(2.005)+(14.001), (I-655)+(2.005)+(14.002), (I-655)+(2.005)+(15.008), (I-655)+(2.005)+(15.011), (I-655)+(2.005)+(15.012), (I-655)+(2.005)+(15.016), (I-655)+(2.005)+(15.025), (I-655)+(2.005)+(15.027), (I-655)+(2.005)+(15.047), (I-655)+(2.005)+(15.063), (I-655)+(2.005)+(15.064), (I-655)+(2.005)+(16.001), (I-655)+(2.005)+(16.002), (I-655)+(2.005)+(16.003), (I-655)+(2.005)+(16.004), (I-655)+(2.005)+(16.005), (I-655)+(2.005)+(16.006), (I-655)+(2.005)+(16.007), (I-655)+(2.005)+(16.008), (I-655)+(2.005)+(17.001), (I-655)+(2.005)+(17.002), (I-655)+(2.005)+(17.003), (I-655)+(2.005)+(17.004), (I-655)+(2.005)+(17.005), (I-655)+(2.005)+(17.006), (I-655)+(2.005)+(17.007), (I-655)+(2.005)+(17.008), (I-655)+(2.005)+(17.009), (I-655)+(2.005)+(17.010), (I-655)+(2.005)+(17.011), (I-655)+(2.005)+(17.012), (I-655)+(2.005)+(18.001),

(I-655)+(2.006)+(3.001), (I-655)+(2.006)+(3.002), (I-655)+(2.006)+(3.003), (I-655)+(2.006)+(3.004), (I-655)+(2.006)+(3.005), (I-655)+(2.006)+(3.006), (I-655)+(2.006)+(3.007), (I-655)+(2.006)+(3.008), (I-655)+(2.006)+(3.009), (I-655)+(2.006)+(3.010), (I-655)+(2.006)+(3.011), (I-655)+(2.006)+(3.012), (I-655)+(2.006)+(3.013), (I-655)+(2.006)+(3.014), (I-655)+(2.006)+(3.015), (I-655)+(2.006)+(3.016), (I-655)+(2.006)+(3.017), (I-655)+(2.006)+(3.018), (I-655)+(2.006)+(3.019), (I-655)+(2.006)+(3.020), (I-655)+(2.006)+(3.021), (I-655)+(2.006)+(3.022), (I-655)+(2.006)+(3.023), (I-655)+(2.006)+(3.024), (I-655)+(2.006)+(3.025), (I-655)+(2.006)+(3.026), (I-655)+(2.006)+(3.027), (I-655)+(2.006)+(3.028), (I-655)+(2.006)+(3.029), (I-655)+(2.006)+(3.030), (I-655)+(2.006)+(3.031), (I-655)+(2.006)+(5.001), (I-655)+(2.006)+(5.002), (I-655)+(2.006)+(5.003), (I-655)+(2.006)+(5.004), (I-655)+(2.006)+(5.005), (I-655)+(2.006)+(5.006), (I-655)+(2.006)+(5.007), (I-655)+(2.006)+(5.008), (I-655)+(2.006)+(5.009), (I-655)+(2.006)+(5.010), (I-655)+(2.006)+(5.011), (I-655)+(2.006)+(5.012), (I-655)+(2.006)+(5.013), (I-655)+(2.006)+(5.014), (I-655)+(2.006)+(5.015), (I-655)+(2.006)+(5.016), (I-655)+(2.006)+(5.017), (I-655)+(2.006)+(5.018), (I-655)+(2.006)+(5.019), (I-655)+(2.006)+(5.020), (I-655)+(2.006)+(5.021), (I-655)+(2.006)+(5.022), (I-655)+(2.006)+(5.023), (I-655)+(2.006)+(6.001), (I-655)+(2.006)+(6.002), (I-655)+(2.006)+(6.003), (I-655)+(2.006)+(6.004), (I-655)+(2.006)+(7.001), (I-655)+(2.006)+(7.002), (I-655)+(2.006)+(7.003), (I-655)+(2.006)+(7.004), (I-655)+(2.006)+(7.005), (I-655)+(2.006)+(7.006), (I-655)+(2.006)+(9.001), (I-655)+(2.006)+(9.002), (I-655)+(2.006)+(9.003), (I-655)+(2.006)+(9.004), (I-655)+(2.006)+(9.005), (I-655)+(2.006)+(9.006), (I-655)+(2.006)+(9.007), (I-655)+(2.006)+(9.008), (I-655)+(2.006)+(9.009), (I-655)+(2.006)+(14.001), (I-655)+(2.006)+(14.002), (I-655)+(2.006)+(15.008), (I-655)+(2.006)+(15.011), (I-655)+(2.006)+(15.012), (I-655)+(2.006)+(15.016), (I-655)+(2.006)+(15.025), (I-655)+(2.006)+(15.027), (I-655)+(2.006)+(15.047), (I-655)+(2.006)+(15.063), (I-655)+(2.006)+(15.064), (I-655)+(2.006)+(16.001), (I-655)+(2.006)+(16.002), (I-655)+(2.006)+(16.003), (I-655)+(2.006)+(16.004), (I-655)+(2.006)+(16.005), (I-655)+(2.006)+(16.006), (I-655)+(2.006)+(16.007), (I-655)+(2.006)+(16.008), (I-655)+(2.006)+(17.001), (I-655)+(2.006)+(17.002), (I-655)+(2.006)+(17.003), (I-655)+(2.006)+(17.004), (I-655)+(2.006)+(17.005), (I-655)+(2.006)+(17.006), (I-655)+(2.006)+(17.007), (I-655)+(2.006)+(17.008), (I-655)+(2.006)+(17.009), (I-655)+(2.006)+(17.010), (I-655)+(2.006)+(17.011), (I-655)+(2.006)+(17.012), (I-655)+(2.006)+(18.001),

(I-655)+(2.007)+(3.001), (I-655)+(2.007)+(3.002), (I-655)+(2.007)+(3.003), (I-655)+(2.007)+(3.004), (I-655)+(2.007)+(3.005), (I-655)+(2.007)+(3.006), (I-655)+(2.007)+(3.007), (I-655)+(2.007)+(3.008), (I-655)+(2.007)+(3.009), (I-655)+(2.007)+(3.010), (I-655)+(2.007)+(3.011), (I-655)+(2.007)+(3.012), (I-655)+(2.007)+(3.013), (I-655)+(2.007)+(3.014), (I-655)+(2.007)+(3.015), (I-655)+(2.007)+(3.016), (I-655)+(2.007)+(3.017), (I-655)+(2.007)+(3.018), (I-655)+(2.007)+(3.019), (I-655)+(2.007)+(3.020), (I-655)+(2.007)+(3.021), (I-655)+(2.007)+(3.022), (I-655)+(2.007)+(3.023), (I-655)+(2.007)+(3.024), (I-655)+(2.007)+(3.025), (I-655)+(2.007)+(3.026), (I-655)+(2.007)+(3.027), (I-655)+(2.007)+(3.028), (I-655)+(2.007)+(3.029), (I-655)+(2.007)+(3.030), (I-655)+(2.007)+(3.031), (I-655)+(2.007)+(5.001), (I-655)+(2.007)+(5.002), (I-655)+(2.007)+(5.003), (I-655)+(2.007)+(5.004), (I-655)+(2.007)+(5.005), (I-655)+(2.007)+(5.006), (I-655)+(2.007)+(5.007), (I-655)+(2.007)+(5.008), (I-655)+(2.007)+(5.009), (I-655)+(2.007)+(5.010), (I-655)+(2.007)+(5.011), (I-655)+(2.007)+(5.012), (I-655)+(2.007)+(5.013), (I-655)+(2.007)+(5.014), (I-655)+(2.007)+(5.015), (I-655)+(2.007)+(5.016), (I-655)+(2.007)+(5.017), (I-655)+(2.007)+(5.018), (I-655)+(2.007)+(5.019), (I-655)+(2.007)+(5.020), (I-655)+(2.007)+(5.021), (I-655)+(2.007)+(5.022), (I-655)+(2.007)+(5.023), (I-655)+(2.007)+(6.001), (I-655)+(2.007)+(6.002), (I-655)+(2.007)+(6.003), (I-655)+(2.007)+(6.004), (I-655)+(2.007)+(7.001), (I-655)+(2.007)+(7.002), (I-655)+(2.007)+(7.003), (I-655)+(2.007)+(7.004), (I-655)+(2.007)+(7.005), (I-655)+(2.007)+(7.006), (I-655)+(2.007)+(9.001), (I-655)+(2.007)+(9.002), (I-655)+(2.007)+(9.003), (I-655)+(2.007)+(9.004), (I-655)+(2.007)+(9.005), (I-655)+(2.007)+(9.006), (I-655)+(2.007)+(9.007), (I-655)+(2.007)+(9.008), (I-655)+(2.007)+(9.009), (I-655)+(2.007)+(14.001), (I-655)+(2.007)+(14.002), (I-655)+(2.007)+(15.008), (I-655)+(2.007)+(15.011), (I-655)+(2.007)+(15.012), (I-655)+(2.007)+(15.016), (I-655)+(2.007)+(15.025), (I-655)+(2.007)+(15.027), (I-655)+(2.007)+(15.047), (I-655)+(2.007)+(15.063), (I-655)+(2.007)+(15.064), (I-655)+(2.007)+(16.001), (I-655)+(2.007)+(16.002), (I-655)+(2.007)+(16.003), (I-655)+(2.007)+(16.004), (I-655)+(2.007)+(16.005), (I-655)+(2.007)+(16.006), (I-655)+(2.007)+(16.007), (I-655)+(2.007)+(16.008), (I-655)+(2.007)+(17.001), (I-655)+(2.007)+(17.002), (I-655)+(2.007)+(17.003), (I-655)+(2.007)+(17.004), (I-655)+(2.007)+(17.005), (I-655)+(2.007)+(17.006), (I-655)+(2.007)+(17.007), (I-655)+(2.007)+(17.008), (I-655)+(2.007)+(17.009), (I-655)+(2.007)+(17.010), (I-655)+(2.007)+(17.011), (I-655)+(2.007)+(17.012), (I-655)+(2.007)+(18.001),

(I-655)+(2.008)+(3.001), (I-655)+(2.008)+(3.002), (I-655)+(2.008)+(3.003), (I-655)+(2.008)+(3.004), (I-655)+(2.008)+(3.005), (I-655)+(2.008)+(3.006), (I-655)+(2.008)+(3.007), (I-655)+(2.008)+(3.008), (I-655)+(2.008)+(3.009), (I-655)+(2.008)+(3.010), (I-655)+(2.008)+(3.011), (I-655)+(2.008)+(3.012), (I-655)+(2.008)+(3.013), (I-655)+(2.008)+(3.014), (I-655)+(2.008)+(3.015), (I-655)+(2.008)+(3.016), (I-655)+(2.008)+(3.017), (I-655)+(2.008)+(3.018), (I-655)+(2.008)+(3.019), (I-655)+(2.008)+(3.020), (I-655)+(2.008)+(3.021), (I-655)+(2.008)+(3.022), (I-655)+(2.008)+(3.023), (I-655)+(2.008)+(3.024), (I-655)+(2.008)+(3.025), (I-655)+(2.008)+(3.026), (I-655)+(2.008)+(3.027), (I-655)+(2.008)+(3.028), (I-655)+(2.008)+(3.029), (I-655)+(2.008)+(3.030), (I-655)+(2.008)+(3.031), (I-655)+(2.008)+(5.001), (I-655)+(2.008)+(5.002), (I-655)+(2.008)+(5.003), (I-655)+(2.008)+(5.004), (I-655)+(2.008)+(5.005), (I-655)+(2.008)+(5.006), (I-655)+(2.008)+(5.007), (I-655)+(2.008)+(5.008), (I-655)+(2.008)+(5.009), (I-655)+(2.008)+(5.010), (I-655)+(2.008)+(5.011), (I-655)+(2.008)+(5.012), (I-655)+(2.008)+(5.013), (I-655)+(2.008)+(5.014), (I-655)+(2.008)+(5.015), (I-655)+(2.008)+(5.016), (I-655)+(2.008)+(5.017), (I-655)+(2.008)+(5.018), (I-655)+(2.008)+(5.019), (I-655)+(2.008)+(5.020), (I-655)+(2.008)+(5.021), (I-655)+(2.008)+(5.022), (I-655)+(2.008)+(5.023), (I-655)+(2.008)+(6.001), (I-655)+(2.008)+(6.002), (I-655)+(2.008)+(6.003), (I-655)+(2.008)+(6.004), (I-655)+(2.008)+(7.001), (I-655)+(2.008)+(7.002), (I-655)+(2.008)+(7.003), (I-655)+(2.008)+(7.004), (I-655)+(2.008)+(7.005), (I-655)+(2.008)+(7.006), (I-655)+(2.008)+(9.001), (I-655)+(2.008)+(9.002), (I-655)+(2.008)+(9.003), (I-655)+(2.008)+(9.004), (I-655)+(2.008)+(9.005), (I-655)+(2.008)+(9.006), (I-655)+(2.008)+(9.007), (I-655)+(2.008)+(9.008), (I-655)+(2.008)+(9.009), (I-655)+(2.008)+(14.001), (I-655)+(2.008)+(14.002), (I-655)+(2.008)+(15.008), (I-655)+(2.008)+(15.011), (I-655)+(2.008)+(15.012), (I-655)+(2.008)+(15.016), (I-655)+(2.008)+(15.025), (I-655)+(2.008)+(15.027), (I-655)+(2.008)+(15.047), (I-655)+(2.008)+(15.063), (I-655)+(2.008)+(15.064), (I-655)+(2.008)+(16.001), (I-655)+(2.008)+(16.002), (I-655)+(2.008)+(16.003), (I-655)+(2.008)+(16.004), (I-655)+(2.008)+(16.005), (I-655)+(2.008)+(16.006), (I-655)+(2.008)+(16.007), (I-655)+(2.008)+(16.008), (I-655)+(2.008)+(17.001), (I-655)+(2.008)+(17.002), (I-655)+(2.008)+(17.003), (I-655)+(2.008)+(17.004), (I-655)+(2.008)+(17.005), (I-655)+(2.008)+(17.006), (I-655)+(2.008)+(17.007), (I-655)+(2.008)+(17.008), (I-655)+(2.008)+(17.009), (I-655)+(2.008)+(17.010), (I-655)+(2.008)+(17.011), (I-655)+(2.008)+(17.012), (I-655)+(2.008)+(18.001),

(I-655)+(2.009)+(3.001), (I-655)+(2.009)+(3.002), (I-655)+(2.009)+(3.003), (I-655)+(2.009)+(3.004), (I-655)+(2.009)+(3.005), (I-655)+(2.009)+(3.006), (I-655)+(2.009)+(3.007), (I-655)+(2.009)+(3.008), (I-655)+(2.009)+(3.009), (I-655)+(2.009)+(3.010), (I-655)+(2.009)+(3.011), (I-655)+(2.009)+(3.012), (I-655)+(2.009)+(3.013), (I-655)+(2.009)+(3.014), (I-655)+(2.009)+(3.015), (I-655)+(2.009)+(3.016), (I-655)+(2.009)+(3.017), (I-655)+(2.009)+(3.018), (I-655)+(2.009)+(3.019), (I-655)+(2.009)+(3.020), (I-655)+(2.009)+(3.021), (I-655)+(2.009)+(3.022), (I-655)+(2.009)+(3.023), (I-655)+(2.009)+(3.024), (I-655)+(2.009)+(3.025), (I-655)+(2.009)+(3.026), (I-655)+(2.009)+(3.027), (I-655)+(2.009)+(3.028), (I-655)+(2.009)+(3.029), (I-655)+(2.009)+(3.030), (I-655)+(2.009)+(3.031), (I-655)+(2.009)+(5.001), (I-655)+(2.009)+(5.002), (I-655)+(2.009)+(5.003), (I-655)+(2.009)+(5.004), (I-655)+(2.009)+(5.005), (I-655)+(2.009)+(5.006), (I-655)+(2.009)+(5.007), (I-655)+(2.009)+(5.008), (I-655)+(2.009)+(5.009), (I-655)+(2.009)+(5.010), (I-655)+(2.009)+(5.011), (I-655)+(2.009)+(5.012), (I-655)+(2.009)+(5.013), (I-655)+(2.009)+(5.014), (I-655)+(2.009)+(5.015), (I-655)+(2.009)+(5.016), (I-655)+(2.009)+(5.017), (I-655)+(2.009)+(5.018), (I-655)+(2.009)+(5.019), (I-655)+(2.009)+(5.020), (I-655)+(2.009)+(5.021), (I-655)+(2.009)+(5.022), (I-655)+(2.009)+(5.023), (I-655)+(2.009)+(6.001), (I-655)+(2.009)+(6.002), (I-655)+(2.009)+(6.003), (I-655)+(2.009)+(6.004), (I-655)+(2.009)+(7.001), (I-655)+(2.009)+(7.002), (I-655)+(2.009)+(7.003), (I-655)+(2.009)+(7.004), (I-655)+(2.009)+(7.005), (I-655)+(2.009)+(7.006), (I-655)+(2.009)+(9.001), (I-655)+(2.009)+(9.002), (I-655)+(2.009)+(9.003), (I-655)+(2.009)+(9.004), (I-655)+(2.009)+(9.005), (I-655)+(2.009)+(9.006), (I-655)+(2.009)+(9.007), (I-655)+(2.009)+(9.008), (I-655)+(2.009)+(9.009), (I-655)+(2.009)+(14.001), (I-655)+(2.009)+(14.002), (I-655)+(2.009)+(15.008), (I-655)+(2.009)+(15.011), (I-655)+(2.009)+(15.012), (I-655)+(2.009)+(15.016), (I-655)+(2.009)+(15.025), (I-655)+(2.009)+(15.027), (I-655)+(2.009)+(15.047), (I-655)+(2.009)+(15.063), (I-655)+(2.009)+(15.064), (I-655)+(2.009)+(16.001), (I-655)+(2.009)+(16.002), (I-655)+(2.009)+(16.003), (I-655)+(2.009)+(16.004), (I-655)+(2.009)+(16.005), (I-655)+(2.009)+(16.006), (I-655)+(2.009)+(16.007), (I-655)+(2.009)+(16.008), (I-655)+(2.009)+(17.001), (I-655)+(2.009)+(17.002), (I-655)+(2.009)+(17.003), (I-655)+(2.009)+(17.004), (I-655)+(2.009)+(17.005), (I-655)+(2.009)+(17.006), (I-655)+(2.009)+(17.007), (I-655)+(2.009)+(17.008), (I-655)+(2.009)+(17.009), (I-655)+(2.009)+(17.010), (I-655)+(2.009)+(17.011), (I-655)+(2.009)+(17.012), (I-655)+(2.009)+(18.001),

(I-655)+(2.010)+(3.001), (I-655)+(2.010)+(3.002), (I-655)+(2.010)+(3.003), (I-655)+(2.010)+(3.004), (I-655)+(2.010)+(3.005), (I-655)+(2.010)+(3.006), (I-655)+(2.010)+(3.007), (I-655)+(2.010)+(3.008), (I-655)+(2.010)+(3.009), (I-655)+(2.010)+(3.010), (I-655)+(2.010)+(3.011), (I-655)+(2.010)+(3.012), (I-655)+(2.010)+(3.013), (I-655)+(2.010)+(3.014), (I-655)+(2.010)+(3.015), (I-655)+(2.010)+(3.016), (I-655)+(2.010)+(3.017), (I-655)+(2.010)+(3.018), (I-655)+(2.010)+(3.019), (I-655)+(2.010)+(3.020), (I-655)+(2.010)+(3.021), (I-655)+(2.010)+(3.022), (I-655)+(2.010)+(3.023), (I-655)+(2.010)+(3.024), (I-655)+(2.010)+(3.025), (I-655)+(2.010)+(3.026), (I-655)+(2.010)+(3.027), (I-655)+(2.010)+(3.028), (I-655)+(2.010)+(3.029), (I-655)+(2.010)+(3.030), (I-655)+(2.010)+(3.031), (I-655)+(2.010)+(5.001), (I-655)+(2.010)+(5.002), (I-655)+(2.010)+(5.003), (I-655)+(2.010)+(5.004), (I-655)+(2.010)+(5.005), (I-655)+(2.010)+(5.006), (I-655)+(2.010)+(5.007), (I-655)+(2.010)+(5.008), (I-655)+(2.010)+(5.009), (I-655)+(2.010)+(5.010), (I-655)+(2.010)+(5.011), (I-655)+(2.010)+(5.012), (I-655)+(2.010)+(5.013), (I-655)+(2.010)+(5.014), (I-655)+(2.010)+(5.015), (I-655)+(2.010)+(5.016), (I-655)+(2.010)+(5.017), (I-655)+(2.010)+(5.018), (I-655)+(2.010)+(5.019), (I-655)+(2.010)+(5.020), (I-655)+(2.010)+(5.021), (I-655)+(2.010)+(5.022), (I-655)+(2.010)+(5.023), (I-655)+(2.010)+(6.001), (I-655)+(2.010)+(6.002), (I-655)+(2.010)+(6.003), (I-655)+(2.010)+(6.004), (I-655)+(2.010)+(7.001), (I-655)+(2.010)+(7.002), (I-655)+(2.010)+(7.003), (I-655)+(2.010)+(7.004), (I-655)+(2.010)+(7.005), (I-655)+(2.010)+(7.006), (I-655)+(2.010)+(9.001), (I-655)+(2.010)+(9.002), (I-655)+(2.010)+(9.003), (I-655)+(2.010)+(9.004), (I-655)+(2.010)+(9.005), (I-655)+(2.010)+(9.006), (I-655)+(2.010)+(9.007), (I-655)+(2.010)+(9.008), (I-655)+(2.010)+(9.009), (I-655)+(2.010)+(14.001), (I-655)+(2.010)+(14.002), (I-655)+(2.010)+(15.008), (I-655)+(2.010)+(15.011), (I-655)+(2.010)+(15.012), (I-655)+(2.010)+(15.016), (I-655)+(2.010)+(15.025), (I-655)+(2.010)+(15.027), (I-655)+(2.010)+(15.047), (I-655)+(2.010)+(15.063), (I-655)+(2.010)+(15.064), (I-655)+(2.010)+(16.001), (I-655)+(2.010)+(16.002), (I-655)+(2.010)+(16.003), (I-655)+(2.010)+(16.004), (I-655)+(2.010)+(16.005), (I-655)+(2.010)+(16.006), (I-655)+(2.010)+(16.007), (I-655)+(2.010)+(16.008), (I-655)+(2.010)+(17.001), (I-655)+(2.010)+(17.002), (I-655)+(2.010)+(17.003), (I-655)+(2.010)+(17.004), (I-655)+(2.010)+(17.005), (I-655)+(2.010)+(17.006), (I-655)+(2.010)+(17.007), (I-655)+(2.010)+(17.008), (I-655)+(2.010)+(17.009), (I-655)+(2.010)+(17.010), (I-655)+(2.010)+(17.011), (I-655)+(2.010)+(17.012), (I-655)+(2.010)+(18.001),

(I-655)+(2.011)+(3.001), (I-655)+(2.011)+(3.002), (I-655)+(2.011)+(3.003), (I-655)+(2.011)+(3.004), (I-655)+(2.011)+(3.005), (I-655)+(2.011)+(3.006), (I-655)+(2.011)+(3.007), (I-655)+(2.011)+(3.008), (I-655)+(2.011)+(3.009), (I-655)+(2.011)+(3.010), (I-655)+(2.011)+(3.011), (I-655)+(2.011)+(3.012), (I-655)+(2.011)+(3.013), (I-655)+(2.011)+(3.014), (I-655)+(2.011)+(3.015), (I-655)+(2.011)+(3.016), (I-655)+(2.011)+(3.017), (I-655)+(2.011)+(3.018), (I-655)+(2.011)+(3.019), (I-655)+(2.011)+(3.020), (I-655)+(2.011)+(3.021), (I-655)+(2.011)+(3.022), (I-655)+(2.011)+(3.023), (I-655)+(2.011)+(3.024), (I-655)+(2.011)+(3.025), (I-655)+(2.011)+(3.026), (I-655)+(2.011)+(3.027), (I-655)+(2.011)+(3.028), (I-655)+(2.011)+(3.029), (I-655)+(2.011)+(3.030), (I-655)+(2.011)+(3.031), (I-655)+(2.011)+(5.001), (I-655)+(2.011)+(5.002), (I-655)+(2.011)+(5.003), (I-655)+(2.011)+(5.004), (I-655)+(2.011)+(5.005), (I-655)+(2.011)+(5.006), (I-655)+(2.011)+(5.007), (I-655)+(2.011)+(5.008), (I-655)+(2.011)+(5.009), (I-655)+(2.011)+(5.010), (I-655)+(2.011)+(5.011), (I-655)+(2.011)+(5.012), (I-655)+(2.011)+(5.013), (I-655)+(2.011)+(5.014), (I-655)+(2.011)+(5.015), (I-655)+(2.011)+(5.016), (I-655)+(2.011)+(5.017), (I-655)+(2.011)+(5.018), (I-655)+(2.011)+(5.019), (I-655)+(2.011)+(5.020), (I-655)+(2.011)+(5.021), (I-655)+(2.011)+(5.022), (I-655)+(2.011)+(5.023), (I-655)+(2.011)+(6.001), (I-655)+(2.011)+(6.002), (I-655)+(2.011)+(6.003), (I-655)+(2.011)+(6.004), (I-655)+(2.011)+(7.001), (I-655)+(2.011)+(7.002), (I-655)+(2.011)+(7.003), (I-655)+(2.011)+(7.004), (I-655)+(2.011)+(7.005), (I-655)+(2.011)+(7.006), (I-655)+(2.011)+(9.001), (I-655)+(2.011)+(9.002), (I-655)+(2.011)+(9.003), (I-655)+(2.011)+(9.004), (I-655)+(2.011)+(9.005), (I-655)+(2.011)+(9.006), (I-655)+(2.011)+(9.007), (I-655)+(2.011)+(9.008), (I-655)+(2.011)+(9.009), (I-655)+(2.011)+(14.001), (I-655)+(2.011)+(14.002), (I-655)+(2.011)+(15.008), (I-655)+(2.011)+(15.011), (I-655)+(2.011)+(15.012), (I-655)+(2.011)+(15.016), (I-655)+(2.011)+(15.025), (I-655)+(2.011)+(15.027), (I-655)+(2.011)+(15.047), (I-655)+(2.011)+(15.063), (I-655)+(2.011)+(15.064), (I-655)+(2.011)+(16.001), (I-655)+(2.011)+(16.002), (I-655)+(2.011)+(16.003), (I-655)+(2.011)+(16.004), (I-655)+(2.011)+(16.005), (I-655)+(2.011)+(16.006), (I-655)+(2.011)+(16.007), (I-655)+(2.011)+(16.008), (I-655)+(2.011)+(17.001), (I-655)+(2.011)+(17.002), (I-655)+(2.011)+(17.003), (I-655)+(2.011)+(17.004), (I-655)+(2.011)+(17.005), (I-655)+(2.011)+(17.006), (I-655)+(2.011)+(17.007), (I-655)+(2.011)+(17.008), (I-655)+(2.011)+(17.009), (I-655)+(2.011)+(17.010), (I-655)+(2.011)+(17.011), (I-655)+(2.011)+(17.012), (I-655)+(2.011)+(18.001),

(I-655)+(2.012)+(3.001), (I-655)+(2.012)+(3.002), (I-655)+(2.012)+(3.003), (I-655)+(2.012)+(3.004), (I-655)+(2.012)+(3.005), (I-655)+(2.012)+(3.006), (I-655)+(2.012)+(3.007), (I-655)+(2.012)+(3.008), (I-655)+(2.012)+(3.009), (I-655)+(2.012)+(3.010), (I-655)+(2.012)+(3.011), (I-655)+(2.012)+(3.012), (I-655)+(2.012)+(3.013), (I-655)+(2.012)+(3.014), (I-655)+(2.012)+(3.015), (I-655)+(2.012)+(3.016), (I-655)+(2.012)+(3.017), (I-655)+(2.012)+(3.018), (I-655)+(2.012)+(3.019), (I-655)+(2.012)+(3.020), (I-655)+(2.012)+(3.021), (I-655)+(2.012)+(3.022), (I-655)+(2.012)+(3.023), (I-655)+(2.012)+(3.024), (I-655)+(2.012)+(3.025), (I-655)+(2.012)+(3.026), (I-655)+(2.012)+(3.027), (I-655)+(2.012)+(3.028), (I-655)+(2.012)+(3.029), (I-655)+(2.012)+(3.030), (I-655)+(2.012)+(3.031), (I-655)+(2.012)+(5.001), (I-655)+(2.012)+(5.002), (I-655)+(2.012)+(5.003), (I-655)+(2.012)+(5.004), (I-655)+(2.012)+(5.005), (I-655)+(2.012)+(5.006), (I-655)+(2.012)+(5.007), (I-655)+(2.012)+(5.008), (I-655)+(2.012)+(5.009), (I-655)+(2.012)+(5.010), (I-655)+(2.012)+(5.011), (I-655)+(2.012)+(5.012), (I-655)+(2.012)+(5.013), (I-655)+(2.012)+(5.014), (I-655)+(2.012)+(5.015), (I-655)+(2.012)+(5.016), (I-655)+(2.012)+(5.017), (I-655)+(2.012)+(5.018), (I-655)+(2.012)+(5.019), (I-655)+(2.012)+(5.020), (I-655)+(2.012)+(5.021), (I-655)+(2.012)+(5.022), (I-655)+(2.012)+(5.023), (I-655)+(2.012)+(6.001), (I-655)+(2.012)+(6.002), (I-655)+(2.012)+(6.003), (I-655)+(2.012)+(6.004), (I-655)+(2.012)+(7.001), (I-655)+(2.012)+(7.002), (I-655)+(2.012)+(7.003), (I-655)+(2.012)+(7.004), (I-655)+(2.012)+(7.005), (I-655)+(2.012)+(7.006), (I-655)+(2.012)+(9.001), (I-655)+(2.012)+(9.002), (I-655)+(2.012)+(9.003), (I-655)+(2.012)+(9.004), (I-655)+(2.012)+(9.005), (I-655)+(2.012)+(9.006), (I-655)+(2.012)+(9.007), (I-655)+(2.012)+(9.008), (I-655)+(2.012)+(9.009), (I-655)+(2.012)+(14.001), (I-655)+(2.012)+(14.002), (I-655)+(2.012)+(15.008), (I-655)+(2.012)+(15.011), (I-655)+(2.012)+(15.012), (I-655)+(2.012)+(15.016), (I-655)+(2.012)+(15.025), (I-655)+(2.012)+(15.027), (I-655)+(2.012)+(15.047), (I-655)+(2.012)+(15.063), (I-655)+(2.012)+(15.064), (I-655)+(2.012)+(16.001), (I-655)+(2.012)+(16.002), (I-655)+(2.012)+(16.003), (I-655)+(2.012)+(16.004), (I-655)+(2.012)+(16.005), (I-655)+(2.012)+(16.006), (I-655)+(2.012)+(16.007), (I-655)+(2.012)+(16.008), (I-655)+(2.012)+(17.001), (I-655)+(2.012)+(17.002), (I-655)+(2.012)+(17.003), (I-655)+(2.012)+(17.004), (I-655)+(2.012)+(17.005), (I-655)+(2.012)+(17.006), (I-655)+(2.012)+(17.007), (I-655)+(2.012)+(17.008), (I-655)+(2.012)+(17.009), (I-655)+(2.012)+(17.010), (I-655)+(2.012)+(17.011), (I-655)+(2.012)+(17.012), (I-655)+(2.012)+(18.001),

(I-655)+(2.013)+(3.001), (I-655)+(2.013)+(3.002), (I-655)+(2.013)+(3.003), (I-655)+(2.013)+(3.004), (I-655)+(2.013)+(3.005), (I-655)+(2.013)+(3.006), (I-655)+(2.013)+(3.007), (I-655)+(2.013)+(3.008), (I-655)+(2.013)+(3.009), (I-655)+(2.013)+(3.010), (I-655)+(2.013)+(3.011), (I-655)+(2.013)+(3.012), (I-655)+(2.013)+(3.013), (I-655)+(2.013)+(3.014), (I-655)+(2.013)+(3.015), (I-655)+(2.013)+(3.016), (I-655)+(2.013)+(3.017), (I-655)+(2.013)+(3.018), (I-655)+(2.013)+(3.019), (I-655)+(2.013)+(3.020), (I-655)+(2.013)+(3.021), (I-655)+(2.013)+(3.022), (I-655)+(2.013)+(3.023), (I-655)+(2.013)+(3.024), (I-655)+(2.013)+(3.025), (I-655)+(2.013)+(3.026), (I-655)+(2.013)+(3.027), (I-655)+(2.013)+(3.028), (I-655)+(2.013)+(3.029), (I-655)+(2.013)+(3.030), (I-655)+(2.013)+(3.031), (I-655)+(2.013)+(5.001), (I-655)+(2.013)+(5.002), (I-655)+(2.013)+(5.003), (I-655)+(2.013)+(5.004), (I-655)+(2.013)+(5.005), (I-655)+(2.013)+(5.006), (I-655)+(2.013)+(5.007), (I-655)+(2.013)+(5.008), (I-655)+(2.013)+(5.009), (I-655)+(2.013)+(5.010), (I-655)+(2.013)+(5.011), (I-655)+(2.013)+(5.012), (I-655)+(2.013)+(5.013), (I-655)+(2.013)+(5.014), (I-655)+(2.013)+(5.015), (I-655)+(2.013)+(5.016), (I-655)+(2.013)+(5.017), (I-655)+(2.013)+(5.018), (I-655)+(2.013)+(5.019), (I-655)+(2.013)+(5.020), (I-655)+(2.013)+(5.021), (I-655)+(2.013)+(5.022), (I-655)+(2.013)+(5.023), (I-655)+(2.013)+(6.001), (I-655)+(2.013)+(6.002), (I-655)+(2.013)+(6.003), (I-655)+(2.013)+(6.004), (I-655)+(2.013)+(7.001), (I-655)+(2.013)+(7.002), (I-655)+(2.013)+(7.003), (I-655)+(2.013)+(7.004), (I-655)+(2.013)+(7.005), (I-655)+(2.013)+(7.006), (I-655)+(2.013)+(9.001), (I-655)+(2.013)+(9.002), (I-655)+(2.013)+(9.003), (I-655)+(2.013)+(9.004), (I-655)+(2.013)+(9.005), (I-655)+(2.013)+(9.006), (I-655)+(2.013)+(9.007), (I-655)+(2.013)+(9.008), (I-655)+(2.013)+(9.009), (I-655)+(2.013)+(14.001), (I-655)+(2.013)+(14.002), (I-655)+(2.013)+(15.008), (I-655)+(2.013)+(15.011), (I-655)+(2.013)+(15.012), (I-655)+(2.013)+(15.016), (I-655)+(2.013)+(15.025), (I-655)+(2.013)+(15.027), (I-655)+(2.013)+(15.047), (I-655)+(2.013)+(15.063), (I-655)+(2.013)+(15.064), (I-655)+(2.013)+(16.001), (I-655)+(2.013)+(16.002), (I-655)+(2.013)+(16.003), (I-655)+(2.013)+(16.004), (I-655)+(2.013)+(16.005), (I-655)+(2.013)+(16.006), (I-655)+(2.013)+(16.007), (I-655)+(2.013)+(16.008), (I-655)+(2.013)+(17.001), (I-655)+(2.013)+(17.002), (I-655)+(2.013)+(17.003), (I-655)+(2.013)+(17.004), (I-655)+(2.013)+(17.005), (I-655)+(2.013)+(17.006), (I-655)+(2.013)+(17.007), (I-655)+(2.013)+(17.008), (I-655)+(2.013)+(17.009), (I-655)+(2.013)+(17.010), (I-655)+(2.013)+(17.011), (I-655)+(2.013)+(17.012), (I-655)+(2.013)+(18.001),

(I-655)+(2.014)+(3.001), (I-655)+(2.014)+(3.002), (I-655)+(2.014)+(3.003), (I-655)+(2.014)+(3.004), (I-655)+(2.014)+(3.005), (I-655)+(2.014)+(3.006), (I-655)+(2.014)+(3.007), (I-655)+(2.014)+(3.008), (I-655)+(2.014)+(3.009), (I-655)+(2.014)+(3.010), (I-655)+(2.014)+(3.011), (I-655)+(2.014)+(3.012), (I-655)+(2.014)+(3.013), (I-655)+(2.014)+(3.014), (I-655)+(2.014)+(3.015), (I-655)+(2.014)+(3.016), (I-655)+(2.014)+(3.017), (I-655)+(2.014)+(3.018), (I-655)+(2.014)+(3.019), (I-655)+(2.014)+(3.020), (I-655)+(2.014)+(3.021), (I-655)+(2.014)+(3.022), (I-655)+(2.014)+(3.023), (I-655)+(2.014)+(3.024), (I-655)+(2.014)+(3.025), (I-655)+(2.014)+(3.026), (I-655)+(2.014)+(3.027), (I-655)+(2.014)+(3.028), (I-655)+(2.014)+(3.029), (I-655)+(2.014)+(3.030), (I-655)+(2.014)+(3.031), (I-655)+(2.014)+(5.001), (I-655)+(2.014)+(5.002), (I-655)+(2.014)+(5.003), (I-655)+(2.014)+(5.004), (I-655)+(2.014)+(5.005), (I-655)+(2.014)+(5.006), (I-655)+(2.014)+(5.007), (I-655)+(2.014)+(5.008), (I-655)+(2.014)+(5.009), (I-655)+(2.014)+(5.010), (I-655)+(2.014)+(5.011), (I-655)+(2.014)+(5.012), (I-655)+(2.014)+(5.013), (I-655)+(2.014)+(5.014), (I-655)+(2.014)+(5.015), (I-655)+(2.014)+(5.016), (I-655)+(2.014)+(5.017), (I-655)+(2.014)+(5.018), (I-655)+(2.014)+(5.019), (I-655)+(2.014)+(5.020), (I-655)+(2.014)+(5.021), (I-655)+(2.014)+(5.022), (I-655)+(2.014)+(5.023), (I-655)+(2.014)+(6.001), (I-655)+(2.014)+(6.002), (I-655)+(2.014)+(6.003), (I-655)+(2.014)+(6.004), (I-655)+(2.014)+(7.001), (I-655)+(2.014)+(7.002), (I-655)+(2.014)+(7.003), (I-655)+(2.014)+(7.004), (I-655)+(2.014)+(7.005), (I-655)+(2.014)+(7.006), (I-655)+(2.014)+(9.001), (I-655)+(2.014)+(9.002), (I-655)+(2.014)+(9.003), (I-655)+(2.014)+(9.004), (I-655)+(2.014)+(9.005), (I-655)+(2.014)+(9.006), (I-655)+(2.014)+(9.007), (I-655)+(2.014)+(9.008), (I-655)+(2.014)+(9.009), (I-655)+(2.014)+(14.001), (I-655)+(2.014)+(14.002), (I-655)+(2.014)+(15.008), (I-655)+(2.014)+(15.011), (I-655)+(2.014)+(15.012), (I-655)+(2.014)+(15.016), (I-655)+(2.014)+(15.025), (I-655)+(2.014)+(15.027), (I-655)+(2.014)+(15.047), (I-655)+(2.014)+(15.063), (I-655)+(2.014)+(15.064), (I-655)+(2.014)+(16.001), (I-655)+(2.014)+(16.002), (I-655)+(2.014)+(16.003), (I-655)+(2.014)+(16.004), (I-655)+(2.014)+(16.005), (I-655)+(2.014)+(16.006), (I-655)+(2.014)+(16.007), (I-655)+(2.014)+(16.008), (I-655)+(2.014)+(17.001), (I-655)+(2.014)+(17.002), (I-655)+(2.014)+(17.003), (I-655)+(2.014)+(17.004), (I-655)+(2.014)+(17.005), (I-655)+(2.014)+(17.006), (I-655)+(2.014)+(17.007), (I-655)+(2.014)+(17.008), (I-655)+(2.014)+(17.009), (I-655)+(2.014)+(17.010), (I-655)+(2.014)+(17.011), (I-655)+(2.014)+(17.012), (I-655)+(2.014)+(18.001),

(I-655)+(2.015)+(3.001), (I-655)+(2.015)+(3.002), (I-655)+(2.015)+(3.003), (I-655)+(2.015)+(3.004), (I-655)+(2.015)+(3.005), (I-655)+(2.015)+(3.006), (I-655)+(2.015)+(3.007), (I-655)+(2.015)+(3.008), (I-655)+(2.015)+(3.009), (I-655)+(2.015)+(3.010), (I-655)+(2.015)+(3.011), (I-655)+(2.015)+(3.012), (I-655)+(2.015)+(3.013), (I-655)+(2.015)+(3.014), (I-655)+(2.015)+(3.015), (I-655)+(2.015)+(3.016), (I-655)+(2.015)+(3.017), (I-655)+(2.015)+(3.018), (I-655)+(2.015)+(3.019), (I-655)+(2.015)+(3.020), (I-655)+(2.015)+(3.021), (I-655)+(2.015)+(3.022), (I-655)+(2.015)+(3.023), (I-655)+(2.015)+(3.024), (I-655)+(2.015)+(3.025), (I-655)+(2.015)+(3.026), (I-655)+(2.015)+(3.027), (I-655)+(2.015)+(3.028), (I-655)+(2.015)+(3.029), (I-655)+(2.015)+(3.030), (I-655)+(2.015)+(3.031), (I-655)+(2.015)+(5.001), (I-655)+(2.015)+(5.002), (I-655)+(2.015)+(5.003), (I-655)+(2.015)+(5.004), (I-655)+(2.015)+(5.005), (I-655)+(2.015)+(5.006), (I-655)+(2.015)+(5.007), (I-655)+(2.015)+(5.008), (I-655)+(2.015)+(5.009), (I-655)+(2.015)+(5.010), (I-655)+(2.015)+(5.011), (I-655)+(2.015)+(5.012), (I-655)+(2.015)+(5.013), (I-655)+(2.015)+(5.014), (I-655)+(2.015)+(5.015), (I-655)+(2.015)+(5.016), (I-655)+(2.015)+(5.017), (I-655)+(2.015)+(5.018), (I-655)+(2.015)+(5.019), (I-655)+(2.015)+(5.020), (I-655)+(2.015)+(5.021), (I-655)+(2.015)+(5.022), (I-655)+(2.015)+(5.023), (I-655)+(2.015)+(6.001), (I-655)+(2.015)+(6.002), (I-655)+(2.015)+(6.003), (I-655)+(2.015)+(6.004), (I-655)+(2.015)+(7.001), (I-655)+(2.015)+(7.002), (I-655)+(2.015)+(7.003), (I-655)+(2.015)+(7.004), (I-655)+(2.015)+(7.005), (I-655)+(2.015)+(7.006), (I-655)+(2.015)+(9.001), (I-655)+(2.015)+(9.002), (I-655)+(2.015)+(9.003), (I-655)+(2.015)+(9.004), (I-655)+(2.015)+(9.005), (I-655)+(2.015)+(9.006), (I-655)+(2.015)+(9.007), (I-655)+(2.015)+(9.008), (I-655)+(2.015)+(9.009), (I-655)+(2.015)+(14.001), (I-655)+(2.015)+(14.002), (I-655)+(2.015)+(15.008), (I-655)+(2.015)+(15.011), (I-655)+(2.015)+(15.012), (I-655)+(2.015)+(15.016), (I-655)+(2.015)+(15.025), (I-655)+(2.015)+(15.027), (I-655)+(2.015)+(15.047), (I-655)+(2.015)+(15.063), (I-655)+(2.015)+(15.064), (I-655)+(2.015)+(16.001), (I-655)+(2.015)+(16.002), (I-655)+(2.015)+(16.003), (I-655)+(2.015)+(16.004), (I-655)+(2.015)+(16.005), (I-655)+(2.015)+(16.006), (I-655)+(2.015)+(16.007), (I-655)+(2.015)+(16.008), (I-655)+(2.015)+(17.001), (I-655)+(2.015)+(17.002), (I-655)+(2.015)+(17.003), (I-655)+(2.015)+(17.004), (I-655)+(2.015)+(17.005), (I-655)+(2.015)+(17.006), (I-655)+(2.015)+(17.007), (I-655)+(2.015)+(17.008), (I-655)+(2.015)+(17.009), (I-655)+(2.015)+(17.010), (I-655)+(2.015)+(17.011), (I-655)+(2.015)+(17.012), (I-655)+(2.015)+(18.001),

(I-655)+(2.016)+(3.001), (I-655)+(2.016)+(3.002), (I-655)+(2.016)+(3.003), (I-655)+(2.016)+(3.004), (I-655)+(2.016)+(3.005), (I-655)+(2.016)+(3.006), (I-655)+(2.016)+(3.007), (I-655)+(2.016)+(3.008), (I-655)+(2.016)+(3.009), (I-655)+(2.016)+(3.010), (I-655)+(2.016)+(3.011), (I-655)+(2.016)+(3.012), (I-655)+(2.016)+(3.013), (I-655)+(2.016)+(3.014), (I-655)+(2.016)+(3.015), (I-655)+(2.016)+(3.016), (I-655)+(2.016)+(3.017), (I-655)+(2.016)+(3.018), (I-655)+(2.016)+(3.019), (I-655)+(2.016)+(3.020), (I-655)+(2.016)+(3.021), (I-655)+(2.016)+(3.022), (I-655)+(2.016)+(3.023), (I-655)+(2.016)+(3.024), (I-655)+(2.016)+(3.025), (I-655)+(2.016)+(3.026), (I-655)+(2.016)+(3.027), (I-655)+(2.016)+(3.028), (I-655)+(2.016)+(3.029), (I-655)+(2.016)+(3.030), (I-655)+(2.016)+(3.031), (I-655)+(2.016)+(5.001), (I-655)+(2.016)+(5.002), (I-655)+(2.016)+(5.003), (I-655)+(2.016)+(5.004), (I-655)+(2.016)+(5.005), (I-655)+(2.016)+(5.006), (I-655)+(2.016)+(5.007), (I-655)+(2.016)+(5.008), (I-655)+(2.016)+(5.009), (I-655)+(2.016)+(5.010), (I-655)+(2.016)+(5.011), (I-655)+(2.016)+(5.012), (I-655)+(2.016)+(5.013), (I-655)+(2.016)+(5.014), (I-655)+(2.016)+(5.015), (I-655)+(2.016)+(5.016), (I-655)+(2.016)+(5.017), (I-655)+(2.016)+(5.018), (I-655)+(2.016)+(5.019), (I-655)+(2.016)+(5.020), (I-655)+(2.016)+(5.021), (I-655)+(2.016)+(5.022), (I-655)+(2.016)+(5.023), (I-655)+(2.016)+(6.001), (I-655)+(2.016)+(6.002), (I-655)+(2.016)+(6.003), (I-655)+(2.016)+(6.004), (I-655)+(2.016)+(7.001), (I-655)+(2.016)+(7.002), (I-655)+(2.016)+(7.003), (I-655)+(2.016)+(7.004), (I-655)+(2.016)+(7.005), (I-655)+(2.016)+(7.006), (I-655)+(2.016)+(9.001), (I-655)+(2.016)+(9.002), (I-655)+(2.016)+(9.003), (I-655)+(2.016)+(9.004), (I-655)+(2.016)+(9.005), (I-655)+(2.016)+(9.006), (I-655)+(2.016)+(9.007), (I-655)+(2.016)+(9.008), (I-655)+(2.016)+(9.009), (I-655)+(2.016)+(14.001), (I-655)+(2.016)+(14.002), (I-655)+(2.016)+(15.008), (I-655)+(2.016)+(15.011), (I-655)+(2.016)+(15.012), (I-655)+(2.016)+(15.016), (I-655)+(2.016)+(15.025), (I-655)+(2.016)+(15.027), (I-655)+(2.016)+(15.047), (I-655)+(2.016)+(15.063), (I-655)+(2.016)+(15.064), (I-655)+(2.016)+(16.001), (I-655)+(2.016)+(16.002), (I-655)+(2.016)+(16.003), (I-655)+(2.016)+(16.004), (I-655)+(2.016)+(16.005), (I-655)+(2.016)+(16.006), (I-655)+(2.016)+(16.007), (I-655)+(2.016)+(16.008), (I-655)+(2.016)+(17.001), (I-655)+(2.016)+(17.002), (I-655)+(2.016)+(17.003), (I-655)+(2.016)+(17.004), (I-655)+(2.016)+(17.005), (I-655)+(2.016)+(17.006), (I-655)+(2.016)+(17.007), (I-655)+(2.016)+(17.008), (I-655)+(2.016)+(17.009), (I-655)+(2.016)+(17.010), (I-655)+(2.016)+(17.011), (I-655)+(2.016)+(17.012), (I-655)+(2.016)+(18.001),

(I-655)+(2.017)+(3.001), (I-655)+(2.017)+(3.002), (I-655)+(2.017)+(3.003), (I-655)+(2.017)+(3.004), (I-655)+(2.017)+(3.005), (I-655)+(2.017)+(3.006), (I-655)+(2.017)+(3.007), (I-655)+(2.017)+(3.008), (I-655)+(2.017)+(3.009), (I-655)+(2.017)+(3.010), (I-655)+(2.017)+(3.011), (I-655)+(2.017)+(3.012), (I-655)+(2.017)+(3.013), (I-655)+(2.017)+(3.014), (I-655)+(2.017)+(3.015), (I-655)+(2.017)+(3.016), (I-655)+(2.017)+(3.017), (I-655)+(2.017)+(3.018), (I-655)+(2.017)+(3.019), (I-655)+(2.017)+(3.020), (I-655)+(2.017)+(3.021), (I-655)+(2.017)+(3.022), (I-655)+(2.017)+(3.023), (I-655)+(2.017)+(3.024), (I-655)+(2.017)+(3.025), (I-655)+(2.017)+(3.026), (I-655)+(2.017)+(3.027), (I-655)+(2.017)+(3.028), (I-655)+(2.017)+(3.029), (I-655)+(2.017)+(3.030), (I-655)+(2.017)+(3.031), (I-655)+(2.017)+(5.001), (I-655)+(2.017)+(5.002), (I-655)+(2.017)+(5.003), (I-655)+(2.017)+(5.004), (I-655)+(2.017)+(5.005), (I-655)+(2.017)+(5.006), (I-655)+(2.017)+(5.007), (I-655)+(2.017)+(5.008), (I-655)+(2.017)+(5.009), (I-655)+(2.017)+(5.010), (I-655)+(2.017)+(5.011), (I-655)+(2.017)+(5.012), (I-655)+(2.017)+(5.013), (I-655)+(2.017)+(5.014), (I-655)+(2.017)+(5.015), (I-655)+(2.017)+(5.016), (I-655)+(2.017)+(5.017), (I-655)+(2.017)+(5.018), (I-655)+(2.017)+(5.019), (I-655)+(2.017)+(5.020), (I-655)+(2.017)+(5.021), (I-655)+(2.017)+(5.022), (I-655)+(2.017)+(5.023), (I-655)+(2.017)+(6.001), (I-655)+(2.017)+(6.002), (I-655)+(2.017)+(6.003), (I-655)+(2.017)+(6.004), (I-655)+(2.017)+(7.001), (I-655)+(2.017)+(7.002), (I-655)+(2.017)+(7.003), (I-655)+(2.017)+(7.004), (I-655)+(2.017)+(7.005), (I-655)+(2.017)+(7.006), (I-655)+(2.017)+(9.001), (I-655)+(2.017)+(9.002), (I-655)+(2.017)+(9.003), (I-655)+(2.017)+(9.004), (I-655)+(2.017)+(9.005), (I-655)+(2.017)+(9.006), (I-655)+(2.017)+(9.007), (I-655)+(2.017)+(9.008), (I-655)+(2.017)+(9.009), (I-655)+(2.017)+(14.001), (I-655)+(2.017)+(14.002), (I-655)+(2.017)+(15.008), (I-655)+(2.017)+(15.011), (I-655)+(2.017)+(15.012), (I-655)+(2.017)+(15.016), (I-655)+(2.017)+(15.025), (I-655)+(2.017)+(15.027), (I-655)+(2.017)+(15.047), (I-655)+(2.017)+(15.063), (I-655)+(2.017)+(15.064), (I-655)+(2.017)+(16.001), (I-655)+(2.017)+(16.002), (I-655)+(2.017)+(16.003), (I-655)+(2.017)+(16.004), (I-655)+(2.017)+(16.005), (I-655)+(2.017)+(16.006), (I-655)+(2.017)+(16.007), (I-655)+(2.017)+(16.008), (I-655)+(2.017)+(17.001), (I-655)+(2.017)+(17.002), (I-655)+(2.017)+(17.003), (I-655)+(2.017)+(17.004), (I-655)+(2.017)+(17.005), (I-655)+(2.017)+(17.006), (I-655)+(2.017)+(17.007), (I-655)+(2.017)+(17.008), (I-655)+(2.017)+(17.009), (I-655)+(2.017)+(17.010), (I-655)+(2.017)+(17.011), (I-655)+(2.017)+(17.012), (I-655)+(2.017)+(18.001),

(I-655)+(2.018)+(3.001), (I-655)+(2.018)+(3.002), (I-655)+(2.018)+(3.003), (I-655)+(2.018)+(3.004), (I-655)+(2.018)+(3.005), (I-655)+(2.018)+(3.006), (I-655)+(2.018)+(3.007), (I-655)+(2.018)+(3.008), (I-655)+(2.018)+(3.009), (I-655)+(2.018)+(3.010), (I-655)+(2.018)+(3.011), (I-655)+(2.018)+(3.012), (I-655)+(2.018)+(3.013), (I-655)+(2.018)+(3.014), (I-655)+(2.018)+(3.015), (I-655)+(2.018)+(3.016), (I-655)+(2.018)+(3.017), (I-655)+(2.018)+(3.018), (I-655)+(2.018)+(3.019), (I-655)+(2.018)+(3.020), (I-655)+(2.018)+(3.021), (I-655)+(2.018)+(3.022), (I-655)+(2.018)+(3.023), (I-655)+(2.018)+(3.024), (I-655)+(2.018)+(3.025), (I-655)+(2.018)+(3.026), (I-655)+(2.018)+(3.027), (I-655)+(2.018)+(3.028), (I-655)+(2.018)+(3.029), (I-655)+(2.018)+(3.030), (I-655)+(2.018)+(3.031), (I-655)+(2.018)+(5.001), (I-655)+(2.018)+(5.002), (I-655)+(2.018)+(5.003), (I-655)+(2.018)+(5.004), (I-655)+(2.018)+(5.005), (I-655)+(2.018)+(5.006), (I-655)+(2.018)+(5.007), (I-655)+(2.018)+(5.008), (I-655)+(2.018)+(5.009), (I-655)+(2.018)+(5.010), (I-655)+(2.018)+(5.011), (I-655)+(2.018)+(5.012), (I-655)+(2.018)+(5.013), (I-655)+(2.018)+(5.014), (I-655)+(2.018)+(5.015), (I-655)+(2.018)+(5.016), (I-655)+(2.018)+(5.017), (I-655)+(2.018)+(5.018), (I-655)+(2.018)+(5.019), (I-655)+(2.018)+(5.020), (I-655)+(2.018)+(5.021), (I-655)+(2.018)+(5.022), (I-655)+(2.018)+(5.023), (I-655)+(2.018)+(6.001), (I-655)+(2.018)+(6.002), (I-655)+(2.018)+(6.003), (I-655)+(2.018)+(6.004), (I-655)+(2.018)+(7.001), (I-655)+(2.018)+(7.002), (I-655)+(2.018)+(7.003), (I-655)+(2.018)+(7.004), (I-655)+(2.018)+(7.005), (I-655)+(2.018)+(7.006), (I-655)+(2.018)+(9.001), (I-655)+(2.018)+(9.002), (I-655)+(2.018)+(9.003), (I-655)+(2.018)+(9.004), (I-655)+(2.018)+(9.005), (I-655)+(2.018)+(9.006), (I-655)+(2.018)+(9.007), (I-655)+(2.018)+(9.008), (I-655)+(2.018)+(9.009), (I-655)+(2.018)+(14.001), (I-655)+(2.018)+(14.002), (I-655)+(2.018)+(15.008), (I-655)+(2.018)+(15.011), (I-655)+(2.018)+(15.012), (I-655)+(2.018)+(15.016), (I-655)+(2.018)+(15.025), (I-655)+(2.018)+(15.027), (I-655)+(2.018)+(15.047), (I-655)+(2.018)+(15.063), (I-655)+(2.018)+(15.064), (I-655)+(2.018)+(16.001), (I-655)+(2.018)+(16.002), (I-655)+(2.018)+(16.003), (I-655)+(2.018)+(16.004), (I-655)+(2.018)+(16.005), (I-655)+(2.018)+(16.006), (I-655)+(2.018)+(16.007), (I-655)+(2.018)+(16.008), (I-655)+(2.018)+(17.001), (I-655)+(2.018)+(17.002), (I-655)+(2.018)+(17.003), (I-655)+(2.018)+(17.004), (I-655)+(2.018)+(17.005), (I-655)+(2.018)+(17.006), (I-655)+(2.018)+(17.007), (I-655)+(2.018)+(17.008), (I-655)+(2.018)+(17.009), (I-655)+(2.018)+(17.010), (I-655)+(2.018)+(17.011), (I-655)+(2.018)+(17.012), (I-655)+(2.018)+(18.001),

(I-655)+(2.019)+(3.001), (I-655)+(2.019)+(3.002), (I-655)+(2.019)+(3.003), (I-655)+(2.019)+(3.004), (I-655)+(2.019)+(3.005), (I-655)+(2.019)+(3.006), (I-655)+(2.019)+(3.007), (I-655)+(2.019)+(3.008), (I-655)+(2.019)+(3.009), (I-655)+(2.019)+(3.010), (I-655)+(2.019)+(3.011), (I-655)+(2.019)+(3.012), (I-655)+(2.019)+(3.013), (I-655)+(2.019)+(3.014), (I-655)+(2.019)+(3.015), (I-655)+(2.019)+(3.016), (I-655)+(2.019)+(3.017), (I-655)+(2.019)+(3.018), (I-655)+(2.019)+(3.019), (I-655)+(2.019)+(3.020), (I-655)+(2.019)+(3.021), (I-655)+(2.019)+(3.022), (I-655)+(2.019)+(3.023), (I-655)+(2.019)+(3.024), (I-655)+(2.019)+(3.025), (I-655)+(2.019)+(3.026), (I-655)+(2.019)+(3.027), (I-655)+(2.019)+(3.028), (I-655)+(2.019)+(3.029), (I-655)+(2.019)+(3.030), (I-655)+(2.019)+(3.031), (I-655)+(2.019)+(5.001), (I-655)+(2.019)+(5.002), (I-655)+(2.019)+(5.003), (I-655)+(2.019)+(5.004), (I-655)+(2.019)+(5.005), (I-655)+(2.019)+(5.006), (I-655)+(2.019)+(5.007), (I-655)+(2.019)+(5.008), (I-655)+(2.019)+(5.009), (I-655)+(2.019)+(5.010), (I-655)+(2.019)+(5.011), (I-655)+(2.019)+(5.012), (I-655)+(2.019)+(5.013), (I-655)+(2.019)+(5.014), (I-655)+(2.019)+(5.015), (I-655)+(2.019)+(5.016), (I-655)+(2.019)+(5.017), (I-655)+(2.019)+(5.018), (I-655)+(2.019)+(5.019), (I-655)+(2.019)+(5.020), (I-655)+(2.019)+(5.021), (I-655)+(2.019)+(5.022), (I-655)+(2.019)+(5.023), (I-655)+(2.019)+(6.001), (I-655)+(2.019)+(6.002), (I-655)+(2.019)+(6.003), (I-655)+(2.019)+(6.004), (I-655)+(2.019)+(7.001), (I-655)+(2.019)+(7.002), (I-655)+(2.019)+(7.003), (I-655)+(2.019)+(7.004), (I-655)+(2.019)+(7.005), (I-655)+(2.019)+(7.006), (I-655)+(2.019)+(9.001), (I-655)+(2.019)+(9.002), (I-655)+(2.019)+(9.003), (I-655)+(2.019)+(9.004), (I-655)+(2.019)+(9.005), (I-655)+(2.019)+(9.006), (I-655)+(2.019)+(9.007), (I-655)+(2.019)+(9.008), (I-655)+(2.019)+(9.009), (I-655)+(2.019)+(14.001), (I-655)+(2.019)+(14.002), (I-655)+(2.019)+(15.008), (I-655)+(2.019)+(15.011), (I-655)+(2.019)+(15.012), (I-655)+(2.019)+(15.016), (I-655)+(2.019)+(15.025), (I-655)+(2.019)+(15.027), (I-655)+(2.019)+(15.047), (I-655)+(2.019)+(15.063), (I-655)+(2.019)+(15.064), (I-655)+(2.019)+(16.001), (I-655)+(2.019)+(16.002), (I-655)+(2.019)+(16.003), (I-655)+(2.019)+(16.004), (I-655)+(2.019)+(16.005), (I-655)+(2.019)+(16.006), (I-655)+(2.019)+(16.007), (I-655)+(2.019)+(16.008), (I-655)+(2.019)+(17.001), (I-655)+(2.019)+(17.002), (I-655)+(2.019)+(17.003), (I-655)+(2.019)+(17.004), (I-655)+(2.019)+(17.005), (I-655)+(2.019)+(17.006), (I-655)+(2.019)+(17.007), (I-655)+(2.019)+(17.008), (I-655)+(2.019)+(17.009), (I-655)+(2.019)+(17.010), (I-655)+(2.019)+(17.011), (I-655)+(2.019)+(17.012), (I-655)+(2.019)+(18.001),

(I-655)+(2.020)+(3.001), (I-655)+(2.020)+(3.002), (I-655)+(2.020)+(3.003), (I-655)+(2.020)+(3.004), (I-655)+(2.020)+(3.005), (I-655)+(2.020)+(3.006), (I-655)+(2.020)+(3.007), (I-655)+(2.020)+(3.008), (I-655)+(2.020)+(3.009), (I-655)+(2.020)+(3.010), (I-655)+(2.020)+(3.011), (I-655)+(2.020)+(3.012), (I-655)+(2.020)+(3.013), (I-655)+(2.020)+(3.014), (I-655)+(2.020)+(3.015), (I-655)+(2.020)+(3.016), (I-655)+(2.020)+(3.017), (I-655)+(2.020)+(3.018), (I-655)+(2.020)+(3.019), (I-655)+(2.020)+(3.020), (I-655)+(2.020)+(3.021), (I-655)+(2.020)+(3.022), (I-655)+(2.020)+(3.023), (I-655)+(2.020)+(3.024), (I-655)+(2.020)+(3.025), (I-655)+(2.020)+(3.026), (I-655)+(2.020)+(3.027), (I-655)+(2.020)+(3.028), (I-655)+(2.020)+(3.029), (I-655)+(2.020)+(3.030), (I-655)+(2.020)+(3.031), (I-655)+(2.020)+(5.001), (I-655)+(2.020)+(5.002), (I-655)+(2.020)+(5.003), (I-655)+(2.020)+(5.004), (I-655)+(2.020)+(5.005), (I-655)+(2.020)+(5.006), (I-655)+(2.020)+(5.007), (I-655)+(2.020)+(5.008), (I-655)+(2.020)+(5.009), (I-655)+(2.020)+(5.010), (I-655)+(2.020)+(5.011), (I-655)+(2.020)+(5.012), (I-655)+(2.020)+(5.013), (I-655)+(2.020)+(5.014), (I-655)+(2.020)+(5.015), (I-655)+(2.020)+(5.016), (I-655)+(2.020)+(5.017), (I-655)+(2.020)+(5.018), (I-655)+(2.020)+(5.019), (I-655)+(2.020)+(5.020), (I-655)+(2.020)+(5.021), (I-655)+(2.020)+(5.022), (I-655)+(2.020)+(5.023), (I-655)+(2.020)+(6.001), (I-655)+(2.020)+(6.002), (I-655)+(2.020)+(6.003), (I-655)+(2.020)+(6.004), (I-655)+(2.020)+(7.001), (I-655)+(2.020)+(7.002), (I-655)+(2.020)+(7.003), (I-655)+(2.020)+(7.004), (I-655)+(2.020)+(7.005), (I-655)+(2.020)+(7.006), (I-655)+(2.020)+(9.001), (I-655)+(2.020)+(9.002), (I-655)+(2.020)+(9.003), (I-655)+(2.020)+(9.004), (I-655)+(2.020)+(9.005), (I-655)+(2.020)+(9.006), (I-655)+(2.020)+(9.007), (I-655)+(2.020)+(9.008), (I-655)+(2.020)+(9.009), (I-655)+(2.020)+(14.001), (I-655)+(2.020)+(14.002), (I-655)+(2.020)+(15.008), (I-655)+(2.020)+(15.011), (I-655)+(2.020)+(15.012), (I-655)+(2.020)+(15.016), (I-655)+(2.020)+(15.025), (I-655)+(2.020)+(15.027), (I-655)+(2.020)+(15.047), (I-655)+(2.020)+(15.063), (I-655)+(2.020)+(15.064), (I-655)+(2.020)+(16.001), (I-655)+(2.020)+(16.002), (I-655)+(2.020)+(16.003), (I-655)+(2.020)+(16.004), (I-655)+(2.020)+(16.005), (I-655)+(2.020)+(16.006), (I-655)+(2.020)+(16.007), (I-655)+(2.020)+(16.008), (I-655)+(2.020)+(17.001), (I-655)+(2.020)+(17.002), (I-655)+(2.020)+(17.003), (I-655)+(2.020)+(17.004), (I-655)+(2.020)+(17.005), (I-655)+(2.020)+(17.006), (I-655)+(2.020)+(17.007), (I-655)+(2.020)+(17.008), (I-655)+(2.020)+(17.009), (I-655)+(2.020)+(17.010), (I-655)+(2.020)+(17.011), (I-655)+(2.020)+(17.012), (I-655)+(2.020)+(18.001),

(I-655)+(2.021)+(3.001), (I-655)+(2.021)+(3.002), (I-655)+(2.021)+(3.003), (I-655)+(2.021)+(3.004), (I-655)+(2.021)+(3.005), (I-655)+(2.021)+(3.006), (I-655)+(2.021)+(3.007), (I-655)+(2.021)+(3.008), (I-655)+(2.021)+(3.009), (I-655)+(2.021)+(3.010), (I-655)+(2.021)+(3.011), (I-655)+(2.021)+(3.012), (I-655)+(2.021)+(3.013), (I-655)+(2.021)+(3.014), (I-655)+(2.021)+(3.015), (I-655)+(2.021)+(3.016), (I-655)+(2.021)+(3.017), (I-655)+(2.021)+(3.018), (I-655)+(2.021)+(3.019), (I-655)+(2.021)+(3.020), (I-655)+(2.021)+(3.021), (I-655)+(2.021)+(3.022), (I-655)+(2.021)+(3.023), (I-655)+(2.021)+(3.024), (I-655)+(2.021)+(3.025), (I-655)+(2.021)+(3.026), (I-655)+(2.021)+(3.027), (I-655)+(2.021)+(3.028), (I-655)+(2.021)+(3.029), (I-655)+(2.021)+(3.030), (I-655)+(2.021)+(3.031), (I-655)+(2.021)+(5.001), (I-655)+(2.021)+(5.002), (I-655)+(2.021)+(5.003), (I-655)+(2.021)+(5.004), (I-655)+(2.021)+(5.005), (I-655)+(2.021)+(5.006), (I-655)+(2.021)+(5.007), (I-655)+(2.021)+(5.008), (I-655)+(2.021)+(5.009), (I-655)+(2.021)+(5.010), (I-655)+(2.021)+(5.011), (I-655)+(2.021)+(5.012), (I-655)+(2.021)+(5.013), (I-655)+(2.021)+(5.014), (I-655)+(2.021)+(5.015), (I-655)+(2.021)+(5.016), (I-655)+(2.021)+(5.017), (I-655)+(2.021)+(5.018), (I-655)+(2.021)+(5.019), (I-655)+(2.021)+(5.020), (I-655)+(2.021)+(5.021), (I-655)+(2.021)+(5.022), (I-655)+(2.021)+(5.023), (I-655)+(2.021)+(6.001), (I-655)+(2.021)+(6.002), (I-655)+(2.021)+(6.003), (I-655)+(2.021)+(6.004), (I-655)+(2.021)+(7.001), (I-655)+(2.021)+(7.002), (I-655)+(2.021)+(7.003), (I-655)+(2.021)+(7.004), (I-655)+(2.021)+(7.005), (I-655)+(2.021)+(7.006), (I-655)+(2.021)+(9.001), (I-655)+(2.021)+(9.002), (I-655)+(2.021)+(9.003), (I-655)+(2.021)+(9.004), (I-655)+(2.021)+(9.005), (I-655)+(2.021)+(9.006), (I-655)+(2.021)+(9.007), (I-655)+(2.021)+(9.008), (I-655)+(2.021)+(9.009), (I-655)+(2.021)+(14.001), (I-655)+(2.021)+(14.002), (I-655)+(2.021)+(15.008), (I-655)+(2.021)+(15.011), (I-655)+(2.021)+(15.012), (I-655)+(2.021)+(15.016), (I-655)+(2.021)+(15.025), (I-655)+(2.021)+(15.027), (I-655)+(2.021)+(15.047), (I-655)+(2.021)+(15.063), (I-655)+(2.021)+(15.064), (I-655)+(2.021)+(16.001), (I-655)+(2.021)+(16.002), (I-655)+(2.021)+(16.003), (I-655)+(2.021)+(16.004), (I-655)+(2.021)+(16.005), (I-655)+(2.021)+(16.006), (I-655)+(2.021)+(16.007), (I-655)+(2.021)+(16.008), (I-655)+(2.021)+(17.001), (I-655)+(2.021)+(17.002), (I-655)+(2.021)+(17.003), (I-655)+(2.021)+(17.004), (I-655)+(2.021)+(17.005), (I-655)+(2.021)+(17.006), (I-655)+(2.021)+(17.007), (I-655)+(2.021)+(17.008), (I-655)+(2.021)+(17.009), (I-655)+(2.021)+(17.010), (I-655)+(2.021)+(17.011), (I-655)+(2.021)+(17.012), (I-655)+(2.021)+(18.001),

(I-655)+(2.022)+(3.001), (I-655)+(2.022)+(3.002), (I-655)+(2.022)+(3.003), (I-655)+(2.022)+(3.004), (I-655)+(2.022)+(3.005), (I-655)+(2.022)+(3.006), (I-655)+(2.022)+(3.007), (I-655)+(2.022)+(3.008), (I-655)+(2.022)+(3.009), (I-655)+(2.022)+(3.010), (I-655)+(2.022)+(3.011), (I-655)+(2.022)+(3.012), (I-655)+(2.022)+(3.013), (I-655)+(2.022)+(3.014), (I-655)+(2.022)+(3.015), (I-655)+(2.022)+(3.016), (I-655)+(2.022)+(3.017), (I-655)+(2.022)+(3.018), (I-655)+(2.022)+(3.019), (I-655)+(2.022)+(3.020), (I-655)+(2.022)+(3.021), (I-655)+(2.022)+(3.022), (I-655)+(2.022)+(3.023), (I-655)+(2.022)+(3.024), (I-655)+(2.022)+(3.025), (I-655)+(2.022)+(3.026), (I-655)+(2.022)+(3.027), (I-655)+(2.022)+(3.028), (I-655)+(2.022)+(3.029), (I-655)+(2.022)+(3.030), (I-655)+(2.022)+(3.031), (I-655)+(2.022)+(5.001), (I-655)+(2.022)+(5.002), (I-655)+(2.022)+(5.003), (I-655)+(2.022)+(5.004), (I-655)+(2.022)+(5.005), (I-655)+(2.022)+(5.006), (I-655)+(2.022)+(5.007), (I-655)+(2.022)+(5.008), (I-655)+(2.022)+(5.009), (I-655)+(2.022)+(5.010), (I-655)+(2.022)+(5.011), (I-655)+(2.022)+(5.012), (I-655)+(2.022)+(5.013), (I-655)+(2.022)+(5.014), (I-655)+(2.022)+(5.015), (I-655)+(2.022)+(5.016), (I-655)+(2.022)+(5.017), (I-655)+(2.022)+(5.018), (I-655)+(2.022)+(5.019), (I-655)+(2.022)+(5.020), (I-655)+(2.022)+(5.021), (I-655)+(2.022)+(5.022), (I-655)+(2.022)+(5.023), (I-655)+(2.022)+(6.001), (I-655)+(2.022)+(6.002), (I-655)+(2.022)+(6.003), (I-655)+(2.022)+(6.004), (I-655)+(2.022)+(7.001), (I-655)+(2.022)+(7.002), (I-655)+(2.022)+(7.003), (I-655)+(2.022)+(7.004), (I-655)+(2.022)+(7.005), (I-655)+(2.022)+(7.006), (I-655)+(2.022)+(9.001), (I-655)+(2.022)+(9.002), (I-655)+(2.022)+(9.003), (I-655)+(2.022)+(9.004), (I-655)+(2.022)+(9.005), (I-655)+(2.022)+(9.006), (I-655)+(2.022)+(9.007), (I-655)+(2.022)+(9.008), (I-655)+(2.022)+(9.009), (I-655)+(2.022)+(14.001), (I-655)+(2.022)+(14.002), (I-655)+(2.022)+(15.008), (I-655)+(2.022)+(15.011), (I-655)+(2.022)+(15.012), (I-655)+(2.022)+(15.016), (I-655)+(2.022)+(15.025), (I-655)+(2.022)+(15.027), (I-655)+(2.022)+(15.047), (I-655)+(2.022)+(15.063), (I-655)+(2.022)+(15.064), (I-655)+(2.022)+(16.001), (I-655)+(2.022)+(16.002), (I-655)+(2.022)+(16.003), (I-655)+(2.022)+(16.004), (I-655)+(2.022)+(16.005), (I-655)+(2.022)+(16.006), (I-655)+(2.022)+(16.007), (I-655)+(2.022)+(16.008), (I-655)+(2.022)+(17.001), (I-655)+(2.022)+(17.002), (I-655)+(2.022)+(17.003), (I-655)+(2.022)+(17.004), (I-655)+(2.022)+(17.005), (I-655)+(2.022)+(17.006), (I-655)+(2.022)+(17.007), (I-655)+(2.022)+(17.008), (I-655)+(2.022)+(17.009), (I-655)+(2.022)+(17.010), (I-655)+(2.022)+(17.011), (I-655)+(2.022)+(17.012), (I-655)+(2.022)+(18.001),

(I-655)+(2.023)+(3.001), (I-655)+(2.023)+(3.002), (I-655)+(2.023)+(3.003), (I-655)+(2.023)+(3.004), (I-655)+(2.023)+(3.005), (I-655)+(2.023)+(3.006), (I-655)+(2.023)+(3.007), (I-655)+(2.023)+(3.008), (I-655)+(2.023)+(3.009), (I-655)+(2.023)+(3.010), (I-655)+(2.023)+(3.011), (I-655)+(2.023)+(3.012), (I-655)+(2.023)+(3.013), (I-655)+(2.023)+(3.014), (I-655)+(2.023)+(3.015), (I-655)+(2.023)+(3.016), (I-655)+(2.023)+(3.017), (I-655)+(2.023)+(3.018), (I-655)+(2.023)+(3.019), (I-655)+(2.023)+(3.020), (I-655)+(2.023)+(3.021), (I-655)+(2.023)+(3.022), (I-655)+(2.023)+(3.023), (I-655)+(2.023)+(3.024), (I-655)+(2.023)+(3.025), (I-655)+(2.023)+(3.026), (I-655)+(2.023)+(3.027), (I-655)+(2.023)+(3.028), (I-655)+(2.023)+(3.029), (I-655)+(2.023)+(3.030), (I-655)+(2.023)+(3.031), (I-655)+(2.023)+(5.001), (I-655)+(2.023)+(5.002), (I-655)+(2.023)+(5.003), (I-655)+(2.023)+(5.004), (I-655)+(2.023)+(5.005), (I-655)+(2.023)+(5.006), (I-655)+(2.023)+(5.007), (I-655)+(2.023)+(5.008), (I-655)+(2.023)+(5.009), (I-655)+(2.023)+(5.010), (I-655)+(2.023)+(5.011), (I-655)+(2.023)+(5.012), (I-655)+(2.023)+(5.013), (I-655)+(2.023)+(5.014), (I-655)+(2.023)+(5.015), (I-655)+(2.023)+(5.016), (I-655)+(2.023)+(5.017), (I-655)+(2.023)+(5.018), (I-655)+(2.023)+(5.019), (I-655)+(2.023)+(5.020), (I-655)+(2.023)+(5.021), (I-655)+(2.023)+(5.022), (I-655)+(2.023)+(5.023), (I-655)+(2.023)+(6.001), (I-655)+(2.023)+(6.002), (I-655)+(2.023)+(6.003), (I-655)+(2.023)+(6.004), (I-655)+(2.023)+(7.001), (I-655)+(2.023)+(7.002), (I-655)+(2.023)+(7.003), (I-655)+(2.023)+(7.004), (I-655)+(2.023)+(7.005), (I-655)+(2.023)+(7.006), (I-655)+(2.023)+(9.001), (I-655)+(2.023)+(9.002), (I-655)+(2.023)+(9.003), (I-655)+(2.023)+(9.004), (I-655)+(2.023)+(9.005), (I-655)+(2.023)+(9.006), (I-655)+(2.023)+(9.007), (I-655)+(2.023)+(9.008), (I-655)+(2.023)+(9.009), (I-655)+(2.023)+(14.001), (I-655)+(2.023)+(14.002), (I-655)+(2.023)+(15.008), (I-655)+(2.023)+(15.011), (I-655)+(2.023)+(15.012), (I-655)+(2.023)+(15.016), (I-655)+(2.023)+(15.025), (I-655)+(2.023)+(15.027), (I-655)+(2.023)+(15.047), (I-655)+(2.023)+(15.063), (I-655)+(2.023)+(15.064), (I-655)+(2.023)+(16.001), (I-655)+(2.023)+(16.002), (I-655)+(2.023)+(16.003), (I-655)+(2.023)+(16.004), (I-655)+(2.023)+(16.005), (I-655)+(2.023)+(16.006), (I-655)+(2.023)+(16.007), (I-655)+(2.023)+(16.008), (I-655)+(2.023)+(17.001), (I-655)+(2.023)+(17.002), (I-655)+(2.023)+(17.003), (I-655)+(2.023)+(17.004), (I-655)+(2.023)+(17.005), (I-655)+(2.023)+(17.006), (I-655)+(2.023)+(17.007), (I-655)+(2.023)+(17.008), (I-655)+(2.023)+(17.009), (I-655)+(2.023)+(17.010), (I-655)+(2.023)+(17.011), (I-655)+(2.023)+(17.012), (I-655)+(2.023)+(18.001),

(I-655)+(2.024)+(3.001), (I-655)+(2.024)+(3.002), (I-655)+(2.024)+(3.003), (I-655)+(2.024)+(3.004), (I-655)+(2.024)+(3.005), (I-655)+(2.024)+(3.006), (I-655)+(2.024)+(3.007), (I-655)+(2.024)+(3.008), (I-655)+(2.024)+(3.009), (I-655)+(2.024)+(3.010), (I-655)+(2.024)+(3.011), (I-655)+(2.024)+(3.012), (I-655)+(2.024)+(3.013), (I-655)+(2.024)+(3.014), (I-655)+(2.024)+(3.015), (I-655)+(2.024)+(3.016), (I-655)+(2.024)+(3.017), (I-655)+(2.024)+(3.018), (I-655)+(2.024)+(3.019), (I-655)+(2.024)+(3.020), (I-655)+(2.024)+(3.021), (I-655)+(2.024)+(3.022), (I-655)+(2.024)+(3.023), (I-655)+(2.024)+(3.024), (I-655)+(2.024)+(3.025), (I-655)+(2.024)+(3.026), (I-655)+(2.024)+(3.027), (I-655)+(2.024)+(3.028), (I-655)+(2.024)+(3.029), (I-655)+(2.024)+(3.030), (I-655)+(2.024)+(3.031), (I-655)+(2.024)+(5.001), (I-655)+(2.024)+(5.002), (I-655)+(2.024)+(5.003), (I-655)+(2.024)+(5.004), (I-655)+(2.024)+(5.005), (I-655)+(2.024)+(5.006), (I-655)+(2.024)+(5.007), (I-655)+(2.024)+(5.008), (I-655)+(2.024)+(5.009), (I-655)+(2.024)+(5.010), (I-655)+(2.024)+(5.011), (I-655)+(2.024)+(5.012), (I-655)+(2.024)+(5.013), (I-655)+(2.024)+(5.014), (I-655)+(2.024)+(5.015), (I-655)+(2.024)+(5.016), (I-655)+(2.024)+(5.017), (I-655)+(2.024)+(5.018), (I-655)+(2.024)+(5.019), (I-655)+(2.024)+(5.020), (I-655)+(2.024)+(5.021), (I-655)+(2.024)+(5.022), (I-655)+(2.024)+(5.023), (I-655)+(2.024)+(6.001), (I-655)+(2.024)+(6.002), (I-655)+(2.024)+(6.003), (I-655)+(2.024)+(6.004), (I-655)+(2.024)+(7.001), (I-655)+(2.024)+(7.002), (I-655)+(2.024)+(7.003), (I-655)+(2.024)+(7.004), (I-655)+(2.024)+(7.005), (I-655)+(2.024)+(7.006), (I-655)+(2.024)+(9.001), (I-655)+(2.024)+(9.002), (I-655)+(2.024)+(9.003), (I-655)+(2.024)+(9.004), (I-655)+(2.024)+(9.005), (I-655)+(2.024)+(9.006), (I-655)+(2.024)+(9.007), (I-655)+(2.024)+(9.008), (I-655)+(2.024)+(9.009), (I-655)+(2.024)+(14.001), (I-655)+(2.024)+(14.002), (I-655)+(2.024)+(15.008), (I-655)+(2.024)+(15.011), (I-655)+(2.024)+(15.012), (I-655)+(2.024)+(15.016), (I-655)+(2.024)+(15.025), (I-655)+(2.024)+(15.027), (I-655)+(2.024)+(15.047), (I-655)+(2.024)+(15.063), (I-655)+(2.024)+(15.064), (I-655)+(2.024)+(16.001), (I-655)+(2.024)+(16.002), (I-655)+(2.024)+(16.003), (I-655)+(2.024)+(16.004), (I-655)+(2.024)+(16.005), (I-655)+(2.024)+(16.006), (I-655)+(2.024)+(16.007), (I-655)+(2.024)+(16.008), (I-655)+(2.024)+(17.001), (I-655)+(2.024)+(17.002), (I-655)+(2.024)+(17.003), (I-655)+(2.024)+(17.004), (I-655)+(2.024)+(17.005), (I-655)+(2.024)+(17.006), (I-655)+(2.024)+(17.007), (I-655)+(2.024)+(17.008), (I-655)+(2.024)+(17.009), (I-655)+(2.024)+(17.010), (I-655)+(2.024)+(17.011), (I-655)+(2.024)+(17.012), (I-655)+(2.024)+(18.001),

(I-655)+(2.025)+(3.001), (I-655)+(2.025)+(3.002), (I-655)+(2.025)+(3.003), (I-655)+(2.025)+(3.004), (I-655)+(2.025)+(3.005), (I-655)+(2.025)+(3.006), (I-655)+(2.025)+(3.007), (I-655)+(2.025)+(3.008), (I-655)+(2.025)+(3.009), (I-655)+(2.025)+(3.010), (I-655)+(2.025)+(3.011), (I-655)+(2.025)+(3.012), (I-655)+(2.025)+(3.013), (I-655)+(2.025)+(3.014), (I-655)+(2.025)+(3.015), (I-655)+(2.025)+(3.016), (I-655)+(2.025)+(3.017), (I-655)+(2.025)+(3.018), (I-655)+(2.025)+(3.019), (I-655)+(2.025)+(3.020), (I-655)+(2.025)+(3.021), (I-655)+(2.025)+(3.022), (I-655)+(2.025)+(3.023), (I-655)+(2.025)+(3.024), (I-655)+(2.025)+(3.025), (I-655)+(2.025)+(3.026), (I-655)+(2.025)+(3.027), (I-655)+(2.025)+(3.028), (I-655)+(2.025)+(3.029), (I-655)+(2.025)+(3.030), (I-655)+(2.025)+(3.031), (I-655)+(2.025)+(5.001), (I-655)+(2.025)+(5.002), (I-655)+(2.025)+(5.003), (I-655)+(2.025)+(5.004), (I-655)+(2.025)+(5.005), (I-655)+(2.025)+(5.006), (I-655)+(2.025)+(5.007), (I-655)+(2.025)+(5.008), (I-655)+(2.025)+(5.009), (I-655)+(2.025)+(5.010), (I-655)+(2.025)+(5.011), (I-655)+(2.025)+(5.012), (I-655)+(2.025)+(5.013), (I-655)+(2.025)+(5.014), (I-655)+(2.025)+(5.015), (I-655)+(2.025)+(5.016), (I-655)+(2.025)+(5.017), (I-655)+(2.025)+(5.018), (I-655)+(2.025)+(5.019), (I-655)+(2.025)+(5.020), (I-655)+(2.025)+(5.021), (I-655)+(2.025)+(5.022), (I-655)+(2.025)+(5.023), (I-655)+(2.025)+(6.001), (I-655)+(2.025)+(6.002), (I-655)+(2.025)+(6.003), (I-655)+(2.025)+(6.004), (I-655)+(2.025)+(7.001), (I-655)+(2.025)+(7.002), (I-655)+(2.025)+(7.003), (I-655)+(2.025)+(7.004), (I-655)+(2.025)+(7.005), (I-655)+(2.025)+(7.006), (I-655)+(2.025)+(9.001), (I-655)+(2.025)+(9.002), (I-655)+(2.025)+(9.003), (I-655)+(2.025)+(9.004), (I-655)+(2.025)+(9.005), (I-655)+(2.025)+(9.006), (I-655)+(2.025)+(9.007), (I-655)+(2.025)+(9.008), (I-655)+(2.025)+(9.009), (I-655)+(2.025)+(14.001), (I-655)+(2.025)+(14.002), (I-655)+(2.025)+(15.008), (I-655)+(2.025)+(15.011), (I-655)+(2.025)+(15.012), (I-655)+(2.025)+(15.016), (I-655)+(2.025)+(15.025), (I-655)+(2.025)+(15.027), (I-655)+(2.025)+(15.047), (I-655)+(2.025)+(15.063), (I-655)+(2.025)+(15.064), (I-655)+(2.025)+(16.001), (I-655)+(2.025)+(16.002), (I-655)+(2.025)+(16.003), (I-655)+(2.025)+(16.004), (I-655)+(2.025)+(16.005), (I-655)+(2.025)+(16.006), (I-655)+(2.025)+(16.007), (I-655)+(2.025)+(16.008), (I-655)+(2.025)+(17.001), (I-655)+(2.025)+(17.002), (I-655)+(2.025)+(17.003), (I-655)+(2.025)+(17.004), (I-655)+(2.025)+(17.005), (I-655)+(2.025)+(17.006), (I-655)+(2.025)+(17.007), (I-655)+(2.025)+(17.008), (I-655)+(2.025)+(17.009), (I-655)+(2.025)+(17.010), (I-655)+(2.025)+(17.011), (I-655)+(2.025)+(17.012), (I-655)+(2.025)+(18.001),

(I-655)+(2.026)+(3.001), (I-655)+(2.026)+(3.002), (I-655)+(2.026)+(3.003), (I-655)+(2.026)+(3.004), (I-655)+(2.026)+(3.005), (I-655)+(2.026)+(3.006), (I-655)+(2.026)+(3.007), (I-655)+(2.026)+(3.008), (I-655)+(2.026)+(3.009), (I-655)+(2.026)+(3.010), (I-655)+(2.026)+(3.011), (I-655)+(2.026)+(3.012), (I-655)+(2.026)+(3.013), (I-655)+(2.026)+(3.014), (I-655)+(2.026)+(3.015), (I-655)+(2.026)+(3.016), (I-655)+(2.026)+(3.017), (I-655)+(2.026)+(3.018), (I-655)+(2.026)+(3.019), (I-655)+(2.026)+(3.020), (I-655)+(2.026)+(3.021), (I-655)+(2.026)+(3.022), (I-655)+(2.026)+(3.023), (I-655)+(2.026)+(3.024), (I-655)+(2.026)+(3.025), (I-655)+(2.026)+(3.026), (I-655)+(2.026)+(3.027), (I-655)+(2.026)+(3.028), (I-655)+(2.026)+(3.029), (I-655)+(2.026)+(3.030), (I-655)+(2.026)+(3.031), (I-655)+(2.026)+(5.001), (I-655)+(2.026)+(5.002), (I-655)+(2.026)+(5.003), (I-655)+(2.026)+(5.004), (I-655)+(2.026)+(5.005), (I-655)+(2.026)+(5.006), (I-655)+(2.026)+(5.007), (I-655)+(2.026)+(5.008), (I-655)+(2.026)+(5.009), (I-655)+(2.026)+(5.010), (I-655)+(2.026)+(5.011), (I-655)+(2.026)+(5.012), (I-655)+(2.026)+(5.013), (I-655)+(2.026)+(5.014), (I-655)+(2.026)+(5.015), (I-655)+(2.026)+(5.016), (I-655)+(2.026)+(5.017), (I-655)+(2.026)+(5.018), (I-655)+(2.026)+(5.019), (I-655)+(2.026)+(5.020), (I-655)+(2.026)+(5.021), (I-655)+(2.026)+(5.022), (I-655)+(2.026)+(5.023), (I-655)+(2.026)+(6.001), (I-655)+(2.026)+(6.002), (I-655)+(2.026)+(6.003), (I-655)+(2.026)+(6.004), (I-655)+(2.026)+(7.001), (I-655)+(2.026)+(7.002), (I-655)+(2.026)+(7.003), (I-655)+(2.026)+(7.004), (I-655)+(2.026)+(7.005), (I-655)+(2.026)+(7.006), (I-655)+(2.026)+(9.001), (I-655)+(2.026)+(9.002), (I-655)+(2.026)+(9.003), (I-655)+(2.026)+(9.004), (I-655)+(2.026)+(9.005), (I-655)+(2.026)+(9.006), (I-655)+(2.026)+(9.007), (I-655)+(2.026)+(9.008), (I-655)+(2.026)+(9.009), (I-655)+(2.026)+(14.001), (I-655)+(2.026)+(14.002), (I-655)+(2.026)+(15.008), (I-655)+(2.026)+(15.011), (I-655)+(2.026)+(15.012), (I-655)+(2.026)+(15.016), (I-655)+(2.026)+(15.025), (I-655)+(2.026)+(15.027), (I-655)+(2.026)+(15.047), (I-655)+(2.026)+(15.063), (I-655)+(2.026)+(15.064), (I-655)+(2.026)+(16.001), (I-655)+(2.026)+(16.002), (I-655)+(2.026)+(16.003), (I-655)+(2.026)+(16.004), (I-655)+(2.026)+(16.005), (I-655)+(2.026)+(16.006), (I-655)+(2.026)+(16.007), (I-655)+(2.026)+(16.008), (I-655)+(2.026)+(17.001), (I-655)+(2.026)+(17.002), (I-655)+(2.026)+(17.003), (I-655)+(2.026)+(17.004), (I-655)+(2.026)+(17.005), (I-655)+(2.026)+(17.006), (I-655)+(2.026)+(17.007), (I-655)+(2.026)+(17.008), (I-655)+(2.026)+(17.009), (I-655)+(2.026)+(17.010), (I-655)+(2.026)+(17.011), (I-655)+(2.026)+(17.012), (I-655)+(2.026)+(18.001),

(I-655)+(2.027)+(3.001), (I-655)+(2.027)+(3.002), (I-655)+(2.027)+(3.003), (I-655)+(2.027)+(3.004), (I-655)+(2.027)+(3.005), (I-655)+(2.027)+(3.006), (I-655)+(2.027)+(3.007), (I-655)+(2.027)+(3.008), (I-655)+(2.027)+(3.009), (I-655)+(2.027)+(3.010), (I-655)+(2.027)+(3.011), (I-655)+(2.027)+(3.012), (I-655)+(2.027)+(3.013), (I-655)+(2.027)+(3.014), (I-655)+(2.027)+(3.015), (I-655)+(2.027)+(3.016), (I-655)+(2.027)+(3.017), (I-655)+(2.027)+(3.018), (I-655)+(2.027)+(3.019), (I-655)+(2.027)+(3.020), (I-655)+(2.027)+(3.021), (I-655)+(2.027)+(3.022), (I-655)+(2.027)+(3.023), (I-655)+(2.027)+(3.024), (I-655)+(2.027)+(3.025), (I-655)+(2.027)+(3.026), (I-655)+(2.027)+(3.027), (I-655)+(2.027)+(3.028), (I-655)+(2.027)+(3.029), (I-655)+(2.027)+(3.030), (I-655)+(2.027)+(3.031), (I-655)+(2.027)+(5.001), (I-655)+(2.027)+(5.002), (I-655)+(2.027)+(5.003), (I-655)+(2.027)+(5.004), (I-655)+(2.027)+(5.005), (I-655)+(2.027)+(5.006), (I-655)+(2.027)+(5.007), (I-655)+(2.027)+(5.008), (I-655)+(2.027)+(5.009), (I-655)+(2.027)+(5.010), (I-655)+(2.027)+(5.011), (I-655)+(2.027)+(5.012), (I-655)+(2.027)+(5.013), (I-655)+(2.027)+(5.014), (I-655)+(2.027)+(5.015), (I-655)+(2.027)+(5.016), (I-655)+(2.027)+(5.017), (I-655)+(2.027)+(5.018), (I-655)+(2.027)+(5.019), (I-655)+(2.027)+(5.020), (I-655)+(2.027)+(5.021), (I-655)+(2.027)+(5.022), (I-655)+(2.027)+(5.023), (I-655)+(2.027)+(6.001), (I-655)+(2.027)+(6.002), (I-655)+(2.027)+(6.003), (I-655)+(2.027)+(6.004), (I-655)+(2.027)+(7.001), (I-655)+(2.027)+(7.002), (I-655)+(2.027)+(7.003), (I-655)+(2.027)+(7.004), (I-655)+(2.027)+(7.005), (I-655)+(2.027)+(7.006), (I-655)+(2.027)+(9.001), (I-655)+(2.027)+(9.002), (I-655)+(2.027)+(9.003), (I-655)+(2.027)+(9.004), (I-655)+(2.027)+(9.005), (I-655)+(2.027)+(9.006), (I-655)+(2.027)+(9.007), (I-655)+(2.027)+(9.008), (I-655)+(2.027)+(9.009), (I-655)+(2.027)+(14.001), (I-655)+(2.027)+(14.002), (I-655)+(2.027)+(15.008), (I-655)+(2.027)+(15.011), (I-655)+(2.027)+(15.012), (I-655)+(2.027)+(15.016), (I-655)+(2.027)+(15.025), (I-655)+(2.027)+(15.027), (I-655)+(2.027)+(15.047), (I-655)+(2.027)+(15.063), (I-655)+(2.027)+(15.064), (I-655)+(2.027)+(16.001), (I-655)+(2.027)+(16.002), (I-655)+(2.027)+(16.003), (I-655)+(2.027)+(16.004), (I-655)+(2.027)+(16.005), (I-655)+(2.027)+(16.006), (I-655)+(2.027)+(16.007), (I-655)+(2.027)+(16.008), (I-655)+(2.027)+(17.001), (I-655)+(2.027)+(17.002), (I-655)+(2.027)+(17.003), (I-655)+(2.027)+(17.004), (I-655)+(2.027)+(17.005), (I-655)+(2.027)+(17.006), (I-655)+(2.027)+(17.007), (I-655)+(2.027)+(17.008), (I-655)+(2.027)+(17.009), (I-655)+(2.027)+(17.010), (I-655)+(2.027)+(17.011), (I-655)+(2.027)+(17.012), (I-655)+(2.027)+(18.001),

(I-655)+(2.028)+(3.001), (I-655)+(2.028)+(3.002), (I-655)+(2.028)+(3.003), (I-655)+(2.028)+(3.004), (I-655)+(2.028)+(3.005), (I-655)+(2.028)+(3.006), (I-655)+(2.028)+(3.007), (I-655)+(2.028)+(3.008), (I-655)+(2.028)+(3.009), (I-655)+(2.028)+(3.010), (I-655)+(2.028)+(3.011), (I-655)+(2.028)+(3.012), (I-655)+(2.028)+(3.013), (I-655)+(2.028)+(3.014), (I-655)+(2.028)+(3.015), (I-655)+(2.028)+(3.016), (I-655)+(2.028)+(3.017), (I-655)+(2.028)+(3.018), (I-655)+(2.028)+(3.019), (I-655)+(2.028)+(3.020), (I-655)+(2.028)+(3.021), (I-655)+(2.028)+(3.022), (I-655)+(2.028)+(3.023), (I-655)+(2.028)+(3.024), (I-655)+(2.028)+(3.025), (I-655)+(2.028)+(3.026), (I-655)+(2.028)+(3.027), (I-655)+(2.028)+(3.028), (I-655)+(2.028)+(3.029), (I-655)+(2.028)+(3.030), (I-655)+(2.028)+(3.031), (I-655)+(2.028)+(5.001), (I-655)+(2.028)+(5.002), (I-655)+(2.028)+(5.003), (I-655)+(2.028)+(5.004), (I-655)+(2.028)+(5.005), (I-655)+(2.028)+(5.006), (I-655)+(2.028)+(5.007), (I-655)+(2.028)+(5.008), (I-655)+(2.028)+(5.009), (I-655)+(2.028)+(5.010), (I-655)+(2.028)+(5.011), (I-655)+(2.028)+(5.012), (I-655)+(2.028)+(5.013), (I-655)+(2.028)+(5.014), (I-655)+(2.028)+(5.015), (I-655)+(2.028)+(5.016), (I-655)+(2.028)+(5.017), (I-655)+(2.028)+(5.018), (I-655)+(2.028)+(5.019), (I-655)+(2.028)+(5.020), (I-655)+(2.028)+(5.021), (I-655)+(2.028)+(5.022), (I-655)+(2.028)+(5.023), (I-655)+(2.028)+(6.001), (I-655)+(2.028)+(6.002), (I-655)+(2.028)+(6.003), (I-655)+(2.028)+(6.004), (I-655)+(2.028)+(7.001), (I-655)+(2.028)+(7.002), (I-655)+(2.028)+(7.003), (I-655)+(2.028)+(7.004), (I-655)+(2.028)+(7.005), (I-655)+(2.028)+(7.006), (I-655)+(2.028)+(9.001), (I-655)+(2.028)+(9.002), (I-655)+(2.028)+(9.003), (I-655)+(2.028)+(9.004), (I-655)+(2.028)+(9.005), (I-655)+(2.028)+(9.006), (I-655)+(2.028)+(9.007), (I-655)+(2.028)+(9.008), (I-655)+(2.028)+(9.009), (I-655)+(2.028)+(14.001), (I-655)+(2.028)+(14.002), (I-655)+(2.028)+(15.008), (I-655)+(2.028)+(15.011), (I-655)+(2.028)+(15.012), (I-655)+(2.028)+(15.016), (I-655)+(2.028)+(15.025), (I-655)+(2.028)+(15.027), (I-655)+(2.028)+(15.047), (I-655)+(2.028)+(15.063), (I-655)+(2.028)+(15.064), (I-655)+(2.028)+(16.001), (I-655)+(2.028)+(16.002), (I-655)+(2.028)+(16.003), (I-655)+(2.028)+(16.004), (I-655)+(2.028)+(16.005), (I-655)+(2.028)+(16.006), (I-655)+(2.028)+(16.007), (I-655)+(2.028)+(16.008), (I-655)+(2.028)+(17.001), (I-655)+(2.028)+(17.002), (I-655)+(2.028)+(17.003), (I-655)+(2.028)+(17.004), (I-655)+(2.028)+(17.005), (I-655)+(2.028)+(17.006), (I-655)+(2.028)+(17.007), (I-655)+(2.028)+(17.008), (I-655)+(2.028)+(17.009), (I-655)+(2.028)+(17.010), (I-655)+(2.028)+(17.011), (I-655)+(2.028)+(17.012), (I-655)+(2.028)+(18.001),

(I-655)+(2.029)+(3.001), (I-655)+(2.029)+(3.002), (I-655)+(2.029)+(3.003), (I-655)+(2.029)+(3.004), (I-655)+(2.029)+(3.005), (I-655)+(2.029)+(3.006), (I-655)+(2.029)+(3.007), (I-655)+(2.029)+(3.008), (I-655)+(2.029)+(3.009), (I-655)+(2.029)+(3.010), (I-655)+(2.029)+(3.011), (I-655)+(2.029)+(3.012), (I-655)+(2.029)+(3.013), (I-655)+(2.029)+(3.014), (I-655)+(2.029)+(3.015), (I-655)+(2.029)+(3.016), (I-655)+(2.029)+(3.017), (I-655)+(2.029)+(3.018), (I-655)+(2.029)+(3.019), (I-655)+(2.029)+(3.020), (I-655)+(2.029)+(3.021), (I-655)+(2.029)+(3.022), (I-655)+(2.029)+(3.023), (I-655)+(2.029)+(3.024), (I-655)+(2.029)+(3.025), (I-655)+(2.029)+(3.026), (I-655)+(2.029)+(3.027), (I-655)+(2.029)+(3.028), (I-655)+(2.029)+(3.029), (I-655)+(2.029)+(3.030), (I-655)+(2.029)+(3.031), (I-655)+(2.029)+(5.001), (I-655)+(2.029)+(5.002), (I-655)+(2.029)+(5.003), (I-655)+(2.029)+(5.004), (I-655)+(2.029)+(5.005), (I-655)+(2.029)+(5.006), (I-655)+(2.029)+(5.007), (I-655)+(2.029)+(5.008), (I-655)+(2.029)+(5.009), (I-655)+(2.029)+(5.010), (I-655)+(2.029)+(5.011), (I-655)+(2.029)+(5.012), (I-655)+(2.029)+(5.013), (I-655)+(2.029)+(5.014), (I-655)+(2.029)+(5.015), (I-655)+(2.029)+(5.016), (I-655)+(2.029)+(5.017), (I-655)+(2.029)+(5.018), (I-655)+(2.029)+(5.019), (I-655)+(2.029)+(5.020), (I-655)+(2.029)+(5.021), (I-655)+(2.029)+(5.022), (I-655)+(2.029)+(5.023), (I-655)+(2.029)+(6.001), (I-655)+(2.029)+(6.002), (I-655)+(2.029)+(6.003), (I-655)+(2.029)+(6.004), (I-655)+(2.029)+(7.001), (I-655)+(2.029)+(7.002), (I-655)+(2.029)+(7.003), (I-655)+(2.029)+(7.004), (I-655)+(2.029)+(7.005), (I-655)+(2.029)+(7.006), (I-655)+(2.029)+(9.001), (I-655)+(2.029)+(9.002), (I-655)+(2.029)+(9.003), (I-655)+(2.029)+(9.004), (I-655)+(2.029)+(9.005), (I-655)+(2.029)+(9.006), (I-655)+(2.029)+(9.007), (I-655)+(2.029)+(9.008), (I-655)+(2.029)+(9.009), (I-655)+(2.029)+(14.001), (I-655)+(2.029)+(14.002), (I-655)+(2.029)+(15.008), (I-655)+(2.029)+(15.011), (I-655)+(2.029)+(15.012), (I-655)+(2.029)+(15.016), (I-655)+(2.029)+(15.025), (I-655)+(2.029)+(15.027), (I-655)+(2.029)+(15.047), (I-655)+(2.029)+(15.063), (I-655)+(2.029)+(15.064), (I-655)+(2.029)+(16.001), (I-655)+(2.029)+(16.002), (I-655)+(2.029)+(16.003), (I-655)+(2.029)+(16.004), (I-655)+(2.029)+(16.005), (I-655)+(2.029)+(16.006), (I-655)+(2.029)+(16.007), (I-655)+(2.029)+(16.008), (I-655)+(2.029)+(17.001), (I-655)+(2.029)+(17.002), (I-655)+(2.029)+(17.003), (I-655)+(2.029)+(17.004), (I-655)+(2.029)+(17.005), (I-655)+(2.029)+(17.006), (I-655)+(2.029)+(17.007), (I-655)+(2.029)+(17.008), (I-655)+(2.029)+(17.009), (I-655)+(2.029)+(17.010), (I-655)+(2.029)+(17.011), (I-655)+(2.029)+(17.012), (I-655)+(2.029)+(18.001),

(I-655)+(2.030)+(3.001), (I-655)+(2.030)+(3.002), (I-655)+(2.030)+(3.003), (I-655)+(2.030)+(3.004), (I-655)+(2.030)+(3.005), (I-655)+(2.030)+(3.006), (I-655)+(2.030)+(3.007), (I-655)+(2.030)+(3.008), (I-655)+(2.030)+(3.009), (I-655)+(2.030)+(3.010), (I-655)+(2.030)+(3.011), (I-655)+(2.030)+(3.012), (I-655)+(2.030)+(3.013), (I-655)+(2.030)+(3.014), (I-655)+(2.030)+(3.015), (I-655)+(2.030)+(3.016), (I-655)+(2.030)+(3.017), (I-655)+(2.030)+(3.018), (I-655)+(2.030)+(3.019), (I-655)+(2.030)+(3.020), (I-655)+(2.030)+(3.021), (I-655)+(2.030)+(3.022), (I-655)+(2.030)+(3.023), (I-655)+(2.030)+(3.024), (I-655)+(2.030)+(3.025), (I-655)+(2.030)+(3.026), (I-655)+(2.030)+(3.027), (I-655)+(2.030)+(3.028), (I-655)+(2.030)+(3.029), (I-655)+(2.030)+(3.030), (I-655)+(2.030)+(3.031), (I-655)+(2.030)+(5.001), (I-655)+(2.030)+(5.002), (I-655)+(2.030)+(5.003), (I-655)+(2.030)+(5.004), (I-655)+(2.030)+(5.005), (I-655)+(2.030)+(5.006), (I-655)+(2.030)+(5.007), (I-655)+(2.030)+(5.008), (I-655)+(2.030)+(5.009), (I-655)+(2.030)+(5.010), (I-655)+(2.030)+(5.011), (I-655)+(2.030)+(5.012), (I-655)+(2.030)+(5.013), (I-655)+(2.030)+(5.014), (I-655)+(2.030)+(5.015), (I-655)+(2.030)+(5.016), (I-655)+(2.030)+(5.017), (I-655)+(2.030)+(5.018), (I-655)+(2.030)+(5.019), (I-655)+(2.030)+(5.020), (I-655)+(2.030)+(5.021), (I-655)+(2.030)+(5.022), (I-655)+(2.030)+(5.023), (I-655)+(2.030)+(6.001), (I-655)+(2.030)+(6.002), (I-655)+(2.030)+(6.003), (I-655)+(2.030)+(6.004), (I-655)+(2.030)+(7.001), (I-655)+(2.030)+(7.002), (I-655)+(2.030)+(7.003), (I-655)+(2.030)+(7.004), (I-655)+(2.030)+(7.005), (I-655)+(2.030)+(7.006), (I-655)+(2.030)+(9.001), (I-655)+(2.030)+(9.002), (I-655)+(2.030)+(9.003), (I-655)+(2.030)+(9.004), (I-655)+(2.030)+(9.005), (I-655)+(2.030)+(9.006), (I-655)+(2.030)+(9.007), (I-655)+(2.030)+(9.008), (I-655)+(2.030)+(9.009), (I-655)+(2.030)+(14.001), (I-655)+(2.030)+(14.002), (I-655)+(2.030)+(15.008), (I-655)+(2.030)+(15.011), (I-655)+(2.030)+(15.012), (I-655)+(2.030)+(15.016), (I-655)+(2.030)+(15.025), (I-655)+(2.030)+(15.027), (I-655)+(2.030)+(15.047), (I-655)+(2.030)+(15.063), (I-655)+(2.030)+(15.064), (I-655)+(2.030)+(16.001), (I-655)+(2.030)+(16.002), (I-655)+(2.030)+(16.003), (I-655)+(2.030)+(16.004), (I-655)+(2.030)+(16.005), (I-655)+(2.030)+(16.006), (I-655)+(2.030)+(16.007), (I-655)+(2.030)+(16.008), (I-655)+(2.030)+(17.001), (I-655)+(2.030)+(17.002), (I-655)+(2.030)+(17.003), (I-655)+(2.030)+(17.004), (I-655)+(2.030)+(17.005), (I-655)+(2.030)+(17.006), (I-655)+(2.030)+(17.007), (I-655)+(2.030)+(17.008), (I-655)+(2.030)+(17.009), (I-655)+(2.030)+(17.010), (I-655)+(2.030)+(17.011), (I-655)+(2.030)+(17.012), (I-655)+(2.030)+(18.001),

(I-655)+(2.031)+(3.001), (I-655)+(2.031)+(3.002), (I-655)+(2.031)+(3.003), (I-655)+(2.031)+(3.004), (I-655)+(2.031)+(3.005), (I-655)+(2.031)+(3.006), (I-655)+(2.031)+(3.007), (I-655)+(2.031)+(3.008), (I-655)+(2.031)+(3.009), (I-655)+(2.031)+(3.010), (I-655)+(2.031)+(3.011), (I-655)+(2.031)+(3.012), (I-655)+(2.031)+(3.013), (I-655)+(2.031)+(3.014), (I-655)+(2.031)+(3.015), (I-655)+(2.031)+(3.016), (I-655)+(2.031)+(3.017), (I-655)+(2.031)+(3.018), (I-655)+(2.031)+(3.019), (I-655)+(2.031)+(3.020), (I-655)+(2.031)+(3.021), (I-655)+(2.031)+(3.022), (I-655)+(2.031)+(3.023), (I-655)+(2.031)+(3.024), (I-655)+(2.031)+(3.025), (I-655)+(2.031)+(3.026), (I-655)+(2.031)+(3.027), (I-655)+(2.031)+(3.028), (I-655)+(2.031)+(3.029), (I-655)+(2.031)+(3.030), (I-655)+(2.031)+(3.031), (I-655)+(2.031)+(5.001), (I-655)+(2.031)+(5.002), (I-655)+(2.031)+(5.003), (I-655)+(2.031)+(5.004), (I-655)+(2.031)+(5.005), (I-655)+(2.031)+(5.006), (I-655)+(2.031)+(5.007), (I-655)+(2.031)+(5.008), (I-655)+(2.031)+(5.009), (I-655)+(2.031)+(5.010), (I-655)+(2.031)+(5.011), (I-655)+(2.031)+(5.012), (I-655)+(2.031)+(5.013), (I-655)+(2.031)+(5.014), (I-655)+(2.031)+(5.015), (I-655)+(2.031)+(5.016), (I-655)+(2.031)+(5.017), (I-655)+(2.031)+(5.018), (I-655)+(2.031)+(5.019), (I-655)+(2.031)+(5.020), (I-655)+(2.031)+(5.021), (I-655)+(2.031)+(5.022), (I-655)+(2.031)+(5.023), (I-655)+(2.031)+(6.001), (I-655)+(2.031)+(6.002), (I-655)+(2.031)+(6.003), (I-655)+(2.031)+(6.004), (I-655)+(2.031)+(7.001), (I-655)+(2.031)+(7.002), (I-655)+(2.031)+(7.003), (I-655)+(2.031)+(7.004), (I-655)+(2.031)+(7.005), (I-655)+(2.031)+(7.006), (I-655)+(2.031)+(9.001), (I-655)+(2.031)+(9.002), (I-655)+(2.031)+(9.003), (I-655)+(2.031)+(9.004), (I-655)+(2.031)+(9.005), (I-655)+(2.031)+(9.006), (I-655)+(2.031)+(9.007), (I-655)+(2.031)+(9.008), (I-655)+(2.031)+(9.009), (I-655)+(2.031)+(14.001), (I-655)+(2.031)+(14.002), (I-655)+(2.031)+(15.008), (I-655)+(2.031)+(15.011), (I-655)+(2.031)+(15.012), (I-655)+(2.031)+(15.016), (I-655)+(2.031)+(15.025), (I-655)+(2.031)+(15.027), (I-655)+(2.031)+(15.047), (I-655)+(2.031)+(15.063), (I-655)+(2.031)+(15.064), (I-655)+(2.031)+(16.001), (I-655)+(2.031)+(16.002), (I-655)+(2.031)+(16.003), (I-655)+(2.031)+(16.004), (I-655)+(2.031)+(16.005), (I-655)+(2.031)+(16.006), (I-655)+(2.031)+(16.007), (I-655)+(2.031)+(16.008), (I-655)+(2.031)+(17.001), (I-655)+(2.031)+(17.002), (I-655)+(2.031)+(17.003), (I-655)+(2.031)+(17.004), (I-655)+(2.031)+(17.005), (I-655)+(2.031)+(17.006), (I-655)+(2.031)+(17.007), (I-655)+(2.031)+(17.008), (I-655)+(2.031)+(17.009), (I-655)+(2.031)+(17.010), (I-655)+(2.031)+(17.011), (I-655)+(2.031)+(17.012), (I-655)+(2.031)+(18.001),

(I-655)+(2.032)+(3.001), (I-655)+(2.032)+(3.002), (I-655)+(2.032)+(3.003), (I-655)+(2.032)+(3.004), (I-655)+(2.032)+(3.005), (I-655)+(2.032)+(3.006), (I-655)+(2.032)+(3.007), (I-655)+(2.032)+(3.008), (I-655)+(2.032)+(3.009), (I-655)+(2.032)+(3.010), (I-655)+(2.032)+(3.011), (I-655)+(2.032)+(3.012), (I-655)+(2.032)+(3.013), (I-655)+(2.032)+(3.014), (I-655)+(2.032)+(3.015), (I-655)+(2.032)+(3.016), (I-655)+(2.032)+(3.017), (I-655)+(2.032)+(3.018), (I-655)+(2.032)+(3.019), (I-655)+(2.032)+(3.020), (I-655)+(2.032)+(3.021), (I-655)+(2.032)+(3.022), (I-655)+(2.032)+(3.023), (I-655)+(2.032)+(3.024), (I-655)+(2.032)+(3.025), (I-655)+(2.032)+(3.026), (I-655)+(2.032)+(3.027), (I-655)+(2.032)+(3.028), (I-655)+(2.032)+(3.029), (I-655)+(2.032)+(3.030), (I-655)+(2.032)+(3.031), (I-655)+(2.032)+(5.001), (I-655)+(2.032)+(5.002), (I-655)+(2.032)+(5.003), (I-655)+(2.032)+(5.004), (I-655)+(2.032)+(5.005), (I-655)+(2.032)+(5.006), (I-655)+(2.032)+(5.007), (I-655)+(2.032)+(5.008), (I-655)+(2.032)+(5.009), (I-655)+(2.032)+(5.010), (I-655)+(2.032)+(5.011), (I-655)+(2.032)+(5.012), (I-655)+(2.032)+(5.013), (I-655)+(2.032)+(5.014), (I-655)+(2.032)+(5.015), (I-655)+(2.032)+(5.016), (I-655)+(2.032)+(5.017), (I-655)+(2.032)+(5.018), (I-655)+(2.032)+(5.019), (I-655)+(2.032)+(5.020), (I-655)+(2.032)+(5.021), (I-655)+(2.032)+(5.022), (I-655)+(2.032)+(5.023), (I-655)+(2.032)+(6.001), (I-655)+(2.032)+(6.002), (I-655)+(2.032)+(6.003), (I-655)+(2.032)+(6.004), (I-655)+(2.032)+(7.001), (I-655)+(2.032)+(7.002), (I-655)+(2.032)+(7.003), (I-655)+(2.032)+(7.004), (I-655)+(2.032)+(7.005), (I-655)+(2.032)+(7.006), (I-655)+(2.032)+(9.001), (I-655)+(2.032)+(9.002), (I-655)+(2.032)+(9.003), (I-655)+(2.032)+(9.004), (I-655)+(2.032)+(9.005), (I-655)+(2.032)+(9.006), (I-655)+(2.032)+(9.007), (I-655)+(2.032)+(9.008), (I-655)+(2.032)+(9.009), (I-655)+(2.032)+(14.001), (I-655)+(2.032)+(14.002), (I-655)+(2.032)+(15.008), (I-655)+(2.032)+(15.011), (I-655)+(2.032)+(15.012), (I-655)+(2.032)+(15.016), (I-655)+(2.032)+(15.025), (I-655)+(2.032)+(15.027), (I-655)+(2.032)+(15.047), (I-655)+(2.032)+(15.063), (I-655)+(2.032)+(15.064), (I-655)+(2.032)+(16.001), (I-655)+(2.032)+(16.002), (I-655)+(2.032)+(16.003), (I-655)+(2.032)+(16.004), (I-655)+(2.032)+(16.005), (I-655)+(2.032)+(16.006), (I-655)+(2.032)+(16.007), (I-655)+(2.032)+(16.008), (I-655)+(2.032)+(17.001), (I-655)+(2.032)+(17.002), (I-655)+(2.032)+(17.003), (I-655)+(2.032)+(17.004), (I-655)+(2.032)+(17.005), (I-655)+(2.032)+(17.006), (I-655)+(2.032)+(17.007), (I-655)+(2.032)+(17.008), (I-655)+(2.032)+(17.009), (I-655)+(2.032)+(17.010), (I-655)+(2.032)+(17.011), (I-655)+(2.032)+(17.012), (I-655)+(2.032)+(18.001),

(I-655)+(2.033)+(3.001), (I-655)+(2.033)+(3.002), (I-655)+(2.033)+(3.003), (I-655)+(2.033)+(3.004), (I-655)+(2.033)+(3.005), (I-655)+(2.033)+(3.006), (I-655)+(2.033)+(3.007), (I-655)+(2.033)+(3.008), (I-655)+(2.033)+(3.009), (I-655)+(2.033)+(3.010), (I-655)+(2.033)+(3.011), (I-655)+(2.033)+(3.012), (I-655)+(2.033)+(3.013), (I-655)+(2.033)+(3.014), (I-655)+(2.033)+(3.015), (I-655)+(2.033)+(3.016), (I-655)+(2.033)+(3.017), (I-655)+(2.033)+(3.018), (I-655)+(2.033)+(3.019), (I-655)+(2.033)+(3.020), (I-655)+(2.033)+(3.021), (I-655)+(2.033)+(3.022), (I-655)+(2.033)+(3.023), (I-655)+(2.033)+(3.024), (I-655)+(2.033)+(3.025), (I-655)+(2.033)+(3.026), (I-655)+(2.033)+(3.027), (I-655)+(2.033)+(3.028), (I-655)+(2.033)+(3.029), (I-655)+(2.033)+(3.030), (I-655)+(2.033)+(3.031), (I-655)+(2.033)+(5.001), (I-655)+(2.033)+(5.002), (I-655)+(2.033)+(5.003), (I-655)+(2.033)+(5.004), (I-655)+(2.033)+(5.005), (I-655)+(2.033)+(5.006), (I-655)+(2.033)+(5.007), (I-655)+(2.033)+(5.008), (I-655)+(2.033)+(5.009), (I-655)+(2.033)+(5.010), (I-655)+(2.033)+(5.011), (I-655)+(2.033)+(5.012), (I-655)+(2.033)+(5.013), (I-655)+(2.033)+(5.014), (I-655)+(2.033)+(5.015), (I-655)+(2.033)+(5.016), (I-655)+(2.033)+(5.017), (I-655)+(2.033)+(5.018), (I-655)+(2.033)+(5.019), (I-655)+(2.033)+(5.020), (I-655)+(2.033)+(5.021), (I-655)+(2.033)+(5.022), (I-655)+(2.033)+(5.023), (I-655)+(2.033)+(6.001), (I-655)+(2.033)+(6.002), (I-655)+(2.033)+(6.003), (I-655)+(2.033)+(6.004), (I-655)+(2.033)+(7.001), (I-655)+(2.033)+(7.002), (I-655)+(2.033)+(7.003), (I-655)+(2.033)+(7.004), (I-655)+(2.033)+(7.005), (I-655)+(2.033)+(7.006), (I-655)+(2.033)+(9.001), (I-655)+(2.033)+(9.002), (I-655)+(2.033)+(9.003), (I-655)+(2.033)+(9.004), (I-655)+(2.033)+(9.005), (I-655)+(2.033)+(9.006), (I-655)+(2.033)+(9.007), (I-655)+(2.033)+(9.008), (I-655)+(2.033)+(9.009), (I-655)+(2.033)+(14.001), (I-655)+(2.033)+(14.002), (I-655)+(2.033)+(15.008), (I-655)+(2.033)+(15.011), (I-655)+(2.033)+(15.012), (I-655)+(2.033)+(15.016), (I-655)+(2.033)+(15.025), (I-655)+(2.033)+(15.027), (I-655)+(2.033)+(15.047), (I-655)+(2.033)+(15.063), (I-655)+(2.033)+(15.064), (I-655)+(2.033)+(16.001), (I-655)+(2.033)+(16.002), (I-655)+(2.033)+(16.003), (I-655)+(2.033)+(16.004), (I-655)+(2.033)+(16.005), (I-655)+(2.033)+(16.006), (I-655)+(2.033)+(16.007), (I-655)+(2.033)+(16.008), (I-655)+(2.033)+(17.001), (I-655)+(2.033)+(17.002), (I-655)+(2.033)+(17.003), (I-655)+(2.033)+(17.004), (I-655)+(2.033)+(17.005), (I-655)+(2.033)+(17.006), (I-655)+(2.033)+(17.007), (I-655)+(2.033)+(17.008), (I-655)+(2.033)+(17.009), (I-655)+(2.033)+(17.010), (I-655)+(2.033)+(17.011), (I-655)+(2.033)+(17.012), (I-655)+(2.033)+(18.001),

(I-655)+(2.034)+(3.001), (I-655)+(2.034)+(3.002), (I-655)+(2.034)+(3.003), (I-655)+(2.034)+(3.004), (I-655)+(2.034)+(3.005), (I-655)+(2.034)+(3.006), (I-655)+(2.034)+(3.007), (I-655)+(2.034)+(3.008), (I-655)+(2.034)+(3.009), (I-655)+(2.034)+(3.010), (I-655)+(2.034)+(3.011), (I-655)+(2.034)+(3.012), (I-655)+(2.034)+(3.013), (I-655)+(2.034)+(3.014), (I-655)+(2.034)+(3.015), (I-655)+(2.034)+(3.016), (I-655)+(2.034)+(3.017), (I-655)+(2.034)+(3.018), (I-655)+(2.034)+(3.019), (I-655)+(2.034)+(3.020), (I-655)+(2.034)+(3.021), (I-655)+(2.034)+(3.022), (I-655)+(2.034)+(3.023), (I-655)+(2.034)+(3.024), (I-655)+(2.034)+(3.025), (I-655)+(2.034)+(3.026), (I-655)+(2.034)+(3.027), (I-655)+(2.034)+(3.028), (I-655)+(2.034)+(3.029), (I-655)+(2.034)+(3.030), (I-655)+(2.034)+(3.031), (I-655)+(2.034)+(5.001), (I-655)+(2.034)+(5.002), (I-655)+(2.034)+(5.003), (I-655)+(2.034)+(5.004), (I-655)+(2.034)+(5.005), (I-655)+(2.034)+(5.006), (I-655)+(2.034)+(5.007), (I-655)+(2.034)+(5.008), (I-655)+(2.034)+(5.009), (I-655)+(2.034)+(5.010), (I-655)+(2.034)+(5.011), (I-655)+(2.034)+(5.012), (I-655)+(2.034)+(5.013), (I-655)+(2.034)+(5.014), (I-655)+(2.034)+(5.015), (I-655)+(2.034)+(5.016), (I-655)+(2.034)+(5.017), (I-655)+(2.034)+(5.018), (I-655)+(2.034)+(5.019), (I-655)+(2.034)+(5.020), (I-655)+(2.034)+(5.021), (I-655)+(2.034)+(5.022), (I-655)+(2.034)+(5.023), (I-655)+(2.034)+(6.001), (I-655)+(2.034)+(6.002), (I-655)+(2.034)+(6.003), (I-655)+(2.034)+(6.004), (I-655)+(2.034)+(7.001), (I-655)+(2.034)+(7.002), (I-655)+(2.034)+(7.003), (I-655)+(2.034)+(7.004), (I-655)+(2.034)+(7.005), (I-655)+(2.034)+(7.006), (I-655)+(2.034)+(9.001), (I-655)+(2.034)+(9.002), (I-655)+(2.034)+(9.003), (I-655)+(2.034)+(9.004), (I-655)+(2.034)+(9.005), (I-655)+(2.034)+(9.006), (I-655)+(2.034)+(9.007), (I-655)+(2.034)+(9.008), (I-655)+(2.034)+(9.009), (I-655)+(2.034)+(14.001), (I-655)+(2.034)+(14.002), (I-655)+(2.034)+(15.008), (I-655)+(2.034)+(15.011), (I-655)+(2.034)+(15.012), (I-655)+(2.034)+(15.016), (I-655)+(2.034)+(15.025), (I-655)+(2.034)+(15.027), (I-655)+(2.034)+(15.047), (I-655)+(2.034)+(15.063), (I-655)+(2.034)+(15.064), (I-655)+(2.034)+(16.001), (I-655)+(2.034)+(16.002), (I-655)+(2.034)+(16.003), (I-655)+(2.034)+(16.004), (I-655)+(2.034)+(16.005), (I-655)+(2.034)+(16.006), (I-655)+(2.034)+(16.007), (I-655)+(2.034)+(16.008), (I-655)+(2.034)+(17.001), (I-655)+(2.034)+(17.002), (I-655)+(2.034)+(17.003), (I-655)+(2.034)+(17.004), (I-655)+(2.034)+(17.005), (I-655)+(2.034)+(17.006), (I-655)+(2.034)+(17.007), (I-655)+(2.034)+(17.008), (I-655)+(2.034)+(17.009), (I-655)+(2.034)+(17.010), (I-655)+(2.034)+(17.011), (I-655)+(2.034)+(17.012), (I-655)+(2.034)+(18.001),

(I-655)+(2.035)+(3.001), (I-655)+(2.035)+(3.002), (I-655)+(2.035)+(3.003), (I-655)+(2.035)+(3.004), (I-655)+(2.035)+(3.005), (I-655)+(2.035)+(3.006), (I-655)+(2.035)+(3.007), (I-655)+(2.035)+(3.008), (I-655)+(2.035)+(3.009), (I-655)+(2.035)+(3.010), (I-655)+(2.035)+(3.011), (I-655)+(2.035)+(3.012), (I-655)+(2.035)+(3.013), (I-655)+(2.035)+(3.014), (I-655)+(2.035)+(3.015), (I-655)+(2.035)+(3.016), (I-655)+(2.035)+(3.017), (I-655)+(2.035)+(3.018), (I-655)+(2.035)+(3.019), (I-655)+(2.035)+(3.020), (I-655)+(2.035)+(3.021), (I-655)+(2.035)+(3.022), (I-655)+(2.035)+(3.023), (I-655)+(2.035)+(3.024), (I-655)+(2.035)+(3.025), (I-655)+(2.035)+(3.026), (I-655)+(2.035)+(3.027), (I-655)+(2.035)+(3.028), (I-655)+(2.035)+(3.029), (I-655)+(2.035)+(3.030), (I-655)+(2.035)+(3.031), (I-655)+(2.035)+(5.001), (I-655)+(2.035)+(5.002), (I-655)+(2.035)+(5.003), (I-655)+(2.035)+(5.004), (I-655)+(2.035)+(5.005), (I-655)+(2.035)+(5.006), (I-655)+(2.035)+(5.007), (I-655)+(2.035)+(5.008), (I-655)+(2.035)+(5.009), (I-655)+(2.035)+(5.010), (I-655)+(2.035)+(5.011), (I-655)+(2.035)+(5.012), (I-655)+(2.035)+(5.013), (I-655)+(2.035)+(5.014), (I-655)+(2.035)+(5.015), (I-655)+(2.035)+(5.016), (I-655)+(2.035)+(5.017), (I-655)+(2.035)+(5.018), (I-655)+(2.035)+(5.019), (I-655)+(2.035)+(5.020), (I-655)+(2.035)+(5.021), (I-655)+(2.035)+(5.022), (I-655)+(2.035)+(5.023), (I-655)+(2.035)+(6.001), (I-655)+(2.035)+(6.002), (I-655)+(2.035)+(6.003), (I-655)+(2.035)+(6.004), (I-655)+(2.035)+(7.001), (I-655)+(2.035)+(7.002), (I-655)+(2.035)+(7.003), (I-655)+(2.035)+(7.004), (I-655)+(2.035)+(7.005), (I-655)+(2.035)+(7.006), (I-655)+(2.035)+(9.001), (I-655)+(2.035)+(9.002), (I-655)+(2.035)+(9.003), (I-655)+(2.035)+(9.004), (I-655)+(2.035)+(9.005), (I-655)+(2.035)+(9.006), (I-655)+(2.035)+(9.007), (I-655)+(2.035)+(9.008), (I-655)+(2.035)+(9.009), (I-655)+(2.035)+(14.001), (I-655)+(2.035)+(14.002), (I-655)+(2.035)+(15.008), (I-655)+(2.035)+(15.011), (I-655)+(2.035)+(15.012), (I-655)+(2.035)+(15.016), (I-655)+(2.035)+(15.025), (I-655)+(2.035)+(15.027), (I-655)+(2.035)+(15.047), (I-655)+(2.035)+(15.063), (I-655)+(2.035)+(15.064), (I-655)+(2.035)+(16.001), (I-655)+(2.035)+(16.002), (I-655)+(2.035)+(16.003), (I-655)+(2.035)+(16.004), (I-655)+(2.035)+(16.005), (I-655)+(2.035)+(16.006), (I-655)+(2.035)+(16.007), (I-655)+(2.035)+(16.008), (I-655)+(2.035)+(17.001), (I-655)+(2.035)+(17.002), (I-655)+(2.035)+(17.003), (I-655)+(2.035)+(17.004), (I-655)+(2.035)+(17.005), (I-655)+(2.035)+(17.006), (I-655)+(2.035)+(17.007), (I-655)+(2.035)+(17.008), (I-655)+(2.035)+(17.009), (I-655)+(2.035)+(17.010), (I-655)+(2.035)+(17.011), (I-655)+(2.035)+(17.012), (I-655)+(2.035)+(18.001),

(I-655)+(2.036)+(3.001), (I-655)+(2.036)+(3.002), (I-655)+(2.036)+(3.003), (I-655)+(2.036)+(3.004), (I-655)+(2.036)+(3.005), (I-655)+(2.036)+(3.006), (I-655)+(2.036)+(3.007), (I-655)+(2.036)+(3.008), (I-655)+(2.036)+(3.009), (I-655)+(2.036)+(3.010), (I-655)+(2.036)+(3.011), (I-655)+(2.036)+(3.012), (I-655)+(2.036)+(3.013), (I-655)+(2.036)+(3.014), (I-655)+(2.036)+(3.015), (I-655)+(2.036)+(3.016), (I-655)+(2.036)+(3.017), (I-655)+(2.036)+(3.018), (I-655)+(2.036)+(3.019), (I-655)+(2.036)+(3.020), (I-655)+(2.036)+(3.021), (I-655)+(2.036)+(3.022), (I-655)+(2.036)+(3.023), (I-655)+(2.036)+(3.024), (I-655)+(2.036)+(3.025), (I-655)+(2.036)+(3.026), (I-655)+(2.036)+(3.027), (I-655)+(2.036)+(3.028), (I-655)+(2.036)+(3.029), (I-655)+(2.036)+(3.030), (I-655)+(2.036)+(3.031), (I-655)+(2.036)+(5.001), (I-655)+(2.036)+(5.002), (I-655)+(2.036)+(5.003), (I-655)+(2.036)+(5.004), (I-655)+(2.036)+(5.005), (I-655)+(2.036)+(5.006), (I-655)+(2.036)+(5.007), (I-655)+(2.036)+(5.008), (I-655)+(2.036)+(5.009), (I-655)+(2.036)+(5.010), (I-655)+(2.036)+(5.011), (I-655)+(2.036)+(5.012), (I-655)+(2.036)+(5.013), (I-655)+(2.036)+(5.014), (I-655)+(2.036)+(5.015), (I-655)+(2.036)+(5.016), (I-655)+(2.036)+(5.017), (I-655)+(2.036)+(5.018), (I-655)+(2.036)+(5.019), (I-655)+(2.036)+(5.020), (I-655)+(2.036)+(5.021), (I-655)+(2.036)+(5.022), (I-655)+(2.036)+(5.023), (I-655)+(2.036)+(6.001), (I-655)+(2.036)+(6.002), (I-655)+(2.036)+(6.003), (I-655)+(2.036)+(6.004), (I-655)+(2.036)+(7.001), (I-655)+(2.036)+(7.002), (I-655)+(2.036)+(7.003), (I-655)+(2.036)+(7.004), (I-655)+(2.036)+(7.005), (I-655)+(2.036)+(7.006), (I-655)+(2.036)+(9.001), (I-655)+(2.036)+(9.002), (I-655)+(2.036)+(9.003), (I-655)+(2.036)+(9.004), (I-655)+(2.036)+(9.005), (I-655)+(2.036)+(9.006), (I-655)+(2.036)+(9.007), (I-655)+(2.036)+(9.008), (I-655)+(2.036)+(9.009), (I-655)+(2.036)+(14.001), (I-655)+(2.036)+(14.002), (I-655)+(2.036)+(15.008), (I-655)+(2.036)+(15.011), (I-655)+(2.036)+(15.012), (I-655)+(2.036)+(15.016), (I-655)+(2.036)+(15.025), (I-655)+(2.036)+(15.027), (I-655)+(2.036)+(15.047), (I-655)+(2.036)+(15.063), (I-655)+(2.036)+(15.064), (I-655)+(2.036)+(16.001), (I-655)+(2.036)+(16.002), (I-655)+(2.036)+(16.003), (I-655)+(2.036)+(16.004), (I-655)+(2.036)+(16.005), (I-655)+(2.036)+(16.006), (I-655)+(2.036)+(16.007), (I-655)+(2.036)+(16.008), (I-655)+(2.036)+(17.001), (I-655)+(2.036)+(17.002), (I-655)+(2.036)+(17.003), (I-655)+(2.036)+(17.004), (I-655)+(2.036)+(17.005), (I-655)+(2.036)+(17.006), (I-655)+(2.036)+(17.007), (I-655)+(2.036)+(17.008), (I-655)+(2.036)+(17.009), (I-655)+(2.036)+(17.010), (I-655)+(2.036)+(17.011), (I-655)+(2.036)+(17.012), (I-655)+(2.036)+(18.001),

(I-655)+(2.037)+(3.001), (I-655)+(2.037)+(3.002), (I-655)+(2.037)+(3.003), (I-655)+(2.037)+(3.004), (I-655)+(2.037)+(3.005), (I-655)+(2.037)+(3.006), (I-655)+(2.037)+(3.007), (I-655)+(2.037)+(3.008), (I-655)+(2.037)+(3.009), (I-655)+(2.037)+(3.010), (I-655)+(2.037)+(3.011), (I-655)+(2.037)+(3.012), (I-655)+(2.037)+(3.013), (I-655)+(2.037)+(3.014), (I-655)+(2.037)+(3.015), (I-655)+(2.037)+(3.016), (I-655)+(2.037)+(3.017), (I-655)+(2.037)+(3.018), (I-655)+(2.037)+(3.019), (I-655)+(2.037)+(3.020), (I-655)+(2.037)+(3.021), (I-655)+(2.037)+(3.022), (I-655)+(2.037)+(3.023), (I-655)+(2.037)+(3.024), (I-655)+(2.037)+(3.025), (I-655)+(2.037)+(3.026), (I-655)+(2.037)+(3.027), (I-655)+(2.037)+(3.028), (I-655)+(2.037)+(3.029), (I-655)+(2.037)+(3.030), (I-655)+(2.037)+(3.031), (I-655)+(2.037)+(5.001), (I-655)+(2.037)+(5.002), (I-655)+(2.037)+(5.003), (I-655)+(2.037)+(5.004), (I-655)+(2.037)+(5.005), (I-655)+(2.037)+(5.006), (I-655)+(2.037)+(5.007), (I-655)+(2.037)+(5.008), (I-655)+(2.037)+(5.009), (I-655)+(2.037)+(5.010), (I-655)+(2.037)+(5.011), (I-655)+(2.037)+(5.012), (I-655)+(2.037)+(5.013), (I-655)+(2.037)+(5.014), (I-655)+(2.037)+(5.015), (I-655)+(2.037)+(5.016), (I-655)+(2.037)+(5.017), (I-655)+(2.037)+(5.018), (I-655)+(2.037)+(5.019), (I-655)+(2.037)+(5.020), (I-655)+(2.037)+(5.021), (I-655)+(2.037)+(5.022), (I-655)+(2.037)+(5.023), (I-655)+(2.037)+(6.001), (I-655)+(2.037)+(6.002), (I-655)+(2.037)+(6.003), (I-655)+(2.037)+(6.004), (I-655)+(2.037)+(7.001), (I-655)+(2.037)+(7.002), (I-655)+(2.037)+(7.003), (I-655)+(2.037)+(7.004), (I-655)+(2.037)+(7.005), (I-655)+(2.037)+(7.006), (I-655)+(2.037)+(9.001), (I-655)+(2.037)+(9.002), (I-655)+(2.037)+(9.003), (I-655)+(2.037)+(9.004), (I-655)+(2.037)+(9.005), (I-655)+(2.037)+(9.006), (I-655)+(2.037)+(9.007), (I-655)+(2.037)+(9.008), (I-655)+(2.037)+(9.009), (I-655)+(2.037)+(14.001), (I-655)+(2.037)+(14.002), (I-655)+(2.037)+(15.008), (I-655)+(2.037)+(15.011), (I-655)+(2.037)+(15.012), (I-655)+(2.037)+(15.016), (I-655)+(2.037)+(15.025), (I-655)+(2.037)+(15.027), (I-655)+(2.037)+(15.047), (I-655)+(2.037)+(15.063), (I-655)+(2.037)+(15.064), (I-655)+(2.037)+(16.001), (I-655)+(2.037)+(16.002), (I-655)+(2.037)+(16.003), (I-655)+(2.037)+(16.004), (I-655)+(2.037)+(16.005), (I-655)+(2.037)+(16.006), (I-655)+(2.037)+(16.007), (I-655)+(2.037)+(16.008), (I-655)+(2.037)+(17.001), (I-655)+(2.037)+(17.002), (I-655)+(2.037)+(17.003), (I-655)+(2.037)+(17.004), (I-655)+(2.037)+(17.005), (I-655)+(2.037)+(17.006), (I-655)+(2.037)+(17.007), (I-655)+(2.037)+(17.008), (I-655)+(2.037)+(17.009), (I-655)+(2.037)+(17.010), (I-655)+(2.037)+(17.011), (I-655)+(2.037)+(17.012), (I-655)+(2.037)+(18.001),

(I-655)+(2.038)+(3.001), (I-655)+(2.038)+(3.002), (I-655)+(2.038)+(3.003), (I-655)+(2.038)+(3.004), (I-655)+(2.038)+(3.005), (I-655)+(2.038)+(3.006), (I-655)+(2.038)+(3.007), (I-655)+(2.038)+(3.008), (I-655)+(2.038)+(3.009), (I-655)+(2.038)+(3.010), (I-655)+(2.038)+(3.011), (I-655)+(2.038)+(3.012), (I-655)+(2.038)+(3.013), (I-655)+(2.038)+(3.014), (I-655)+(2.038)+(3.015), (I-655)+(2.038)+(3.016), (I-655)+(2.038)+(3.017), (I-655)+(2.038)+(3.018), (I-655)+(2.038)+(3.019), (I-655)+(2.038)+(3.020), (I-655)+(2.038)+(3.021), (I-655)+(2.038)+(3.022), (I-655)+(2.038)+(3.023), (I-655)+(2.038)+(3.024), (I-655)+(2.038)+(3.025), (I-655)+(2.038)+(3.026), (I-655)+(2.038)+(3.027), (I-655)+(2.038)+(3.028), (I-655)+(2.038)+(3.029), (I-655)+(2.038)+(3.030), (I-655)+(2.038)+(3.031), (I-655)+(2.038)+(5.001), (I-655)+(2.038)+(5.002), (I-655)+(2.038)+(5.003), (I-655)+(2.038)+(5.004), (I-655)+(2.038)+(5.005), (I-655)+(2.038)+(5.006), (I-655)+(2.038)+(5.007), (I-655)+(2.038)+(5.008), (I-655)+(2.038)+(5.009), (I-655)+(2.038)+(5.010), (I-655)+(2.038)+(5.011), (I-655)+(2.038)+(5.012), (I-655)+(2.038)+(5.013), (I-655)+(2.038)+(5.014), (I-655)+(2.038)+(5.015), (I-655)+(2.038)+(5.016), (I-655)+(2.038)+(5.017), (I-655)+(2.038)+(5.018), (I-655)+(2.038)+(5.019), (I-655)+(2.038)+(5.020), (I-655)+(2.038)+(5.021), (I-655)+(2.038)+(5.022), (I-655)+(2.038)+(5.023), (I-655)+(2.038)+(6.001), (I-655)+(2.038)+(6.002), (I-655)+(2.038)+(6.003), (I-655)+(2.038)+(6.004), (I-655)+(2.038)+(7.001), (I-655)+(2.038)+(7.002), (I-655)+(2.038)+(7.003), (I-655)+(2.038)+(7.004), (I-655)+(2.038)+(7.005), (I-655)+(2.038)+(7.006), (I-655)+(2.038)+(9.001), (I-655)+(2.038)+(9.002), (I-655)+(2.038)+(9.003), (I-655)+(2.038)+(9.004), (I-655)+(2.038)+(9.005), (I-655)+(2.038)+(9.006), (I-655)+(2.038)+(9.007), (I-655)+(2.038)+(9.008), (I-655)+(2.038)+(9.009), (I-655)+(2.038)+(14.001), (I-655)+(2.038)+(14.002), (I-655)+(2.038)+(15.008), (I-655)+(2.038)+(15.011), (I-655)+(2.038)+(15.012), (I-655)+(2.038)+(15.016), (I-655)+(2.038)+(15.025), (I-655)+(2.038)+(15.027), (I-655)+(2.038)+(15.047), (I-655)+(2.038)+(15.063), (I-655)+(2.038)+(15.064), (I-655)+(2.038)+(16.001), (I-655)+(2.038)+(16.002), (I-655)+(2.038)+(16.003), (I-655)+(2.038)+(16.004), (I-655)+(2.038)+(16.005), (I-655)+(2.038)+(16.006), (I-655)+(2.038)+(16.007), (I-655)+(2.038)+(16.008), (I-655)+(2.038)+(17.001), (I-655)+(2.038)+(17.002), (I-655)+(2.038)+(17.003), (I-655)+(2.038)+(17.004), (I-655)+(2.038)+(17.005), (I-655)+(2.038)+(17.006), (I-655)+(2.038)+(17.007), (I-655)+(2.038)+(17.008), (I-655)+(2.038)+(17.009), (I-655)+(2.038)+(17.010), (I-655)+(2.038)+(17.011), (I-655)+(2.038)+(17.012), (I-655)+(2.038)+(18.001),

(I-655)+(2.039)+(3.001), (I-655)+(2.039)+(3.002), (I-655)+(2.039)+(3.003), (I-655)+(2.039)+(3.004), (I-655)+(2.039)+(3.005), (I-655)+(2.039)+(3.006), (I-655)+(2.039)+(3.007), (I-655)+(2.039)+(3.008), (I-655)+(2.039)+(3.009), (I-655)+(2.039)+(3.010), (I-655)+(2.039)+(3.011), (I-655)+(2.039)+(3.012), (I-655)+(2.039)+(3.013), (I-655)+(2.039)+(3.014), (I-655)+(2.039)+(3.015), (I-655)+(2.039)+(3.016), (I-655)+(2.039)+(3.017), (I-655)+(2.039)+(3.018), (I-655)+(2.039)+(3.019), (I-655)+(2.039)+(3.020), (I-655)+(2.039)+(3.021), (I-655)+(2.039)+(3.022), (I-655)+(2.039)+(3.023), (I-655)+(2.039)+(3.024), (I-655)+(2.039)+(3.025), (I-655)+(2.039)+(3.026), (I-655)+(2.039)+(3.027), (I-655)+(2.039)+(3.028), (I-655)+(2.039)+(3.029), (I-655)+(2.039)+(3.030), (I-655)+(2.039)+(3.031), (I-655)+(2.039)+(5.001), (I-655)+(2.039)+(5.002), (I-655)+(2.039)+(5.003), (I-655)+(2.039)+(5.004), (I-655)+(2.039)+(5.005), (I-655)+(2.039)+(5.006), (I-655)+(2.039)+(5.007), (I-655)+(2.039)+(5.008), (I-655)+(2.039)+(5.009), (I-655)+(2.039)+(5.010), (I-655)+(2.039)+(5.011), (I-655)+(2.039)+(5.012), (I-655)+(2.039)+(5.013), (I-655)+(2.039)+(5.014), (I-655)+(2.039)+(5.015), (I-655)+(2.039)+(5.016), (I-655)+(2.039)+(5.017), (I-655)+(2.039)+(5.018), (I-655)+(2.039)+(5.019), (I-655)+(2.039)+(5.020), (I-655)+(2.039)+(5.021), (I-655)+(2.039)+(5.022), (I-655)+(2.039)+(5.023), (I-655)+(2.039)+(6.001), (I-655)+(2.039)+(6.002), (I-655)+(2.039)+(6.003), (I-655)+(2.039)+(6.004), (I-655)+(2.039)+(7.001), (I-655)+(2.039)+(7.002), (I-655)+(2.039)+(7.003), (I-655)+(2.039)+(7.004), (I-655)+(2.039)+(7.005), (I-655)+(2.039)+(7.006), (I-655)+(2.039)+(9.001), (I-655)+(2.039)+(9.002), (I-655)+(2.039)+(9.003), (I-655)+(2.039)+(9.004), (I-655)+(2.039)+(9.005), (I-655)+(2.039)+(9.006), (I-655)+(2.039)+(9.007), (I-655)+(2.039)+(9.008), (I-655)+(2.039)+(9.009), (I-655)+(2.039)+(14.001), (I-655)+(2.039)+(14.002), (I-655)+(2.039)+(15.008), (I-655)+(2.039)+(15.011), (I-655)+(2.039)+(15.012), (I-655)+(2.039)+(15.016), (I-655)+(2.039)+(15.025), (I-655)+(2.039)+(15.027), (I-655)+(2.039)+(15.047), (I-655)+(2.039)+(15.063), (I-655)+(2.039)+(15.064), (I-655)+(2.039)+(16.001), (I-655)+(2.039)+(16.002), (I-655)+(2.039)+(16.003), (I-655)+(2.039)+(16.004), (I-655)+(2.039)+(16.005), (I-655)+(2.039)+(16.006), (I-655)+(2.039)+(16.007), (I-655)+(2.039)+(16.008), (I-655)+(2.039)+(17.001), (I-655)+(2.039)+(17.002), (I-655)+(2.039)+(17.003), (I-655)+(2.039)+(17.004), (I-655)+(2.039)+(17.005), (I-655)+(2.039)+(17.006), (I-655)+(2.039)+(17.007), (I-655)+(2.039)+(17.008), (I-655)+(2.039)+(17.009), (I-655)+(2.039)+(17.010), (I-655)+(2.039)+(17.011), (I-655)+(2.039)+(17.012), (I-655)+(2.039)+(18.001),

(I-655)+(2.040)+(3.001), (I-655)+(2.040)+(3.002), (I-655)+(2.040)+(3.003), (I-655)+(2.040)+(3.004), (I-655)+(2.040)+(3.005), (I-655)+(2.040)+(3.006), (I-655)+(2.040)+(3.007), (I-655)+(2.040)+(3.008), (I-655)+(2.040)+(3.009), (I-655)+(2.040)+(3.010), (I-655)+(2.040)+(3.011), (I-655)+(2.040)+(3.012), (I-655)+(2.040)+(3.013), (I-655)+(2.040)+(3.014), (I-655)+(2.040)+(3.015), (I-655)+(2.040)+(3.016), (I-655)+(2.040)+(3.017), (I-655)+(2.040)+(3.018), (I-655)+(2.040)+(3.019), (I-655)+(2.040)+(3.020), (I-655)+(2.040)+(3.021), (I-655)+(2.040)+(3.022), (I-655)+(2.040)+(3.023), (I-655)+(2.040)+(3.024), (I-655)+(2.040)+(3.025), (I-655)+(2.040)+(3.026), (I-655)+(2.040)+(3.027), (I-655)+(2.040)+(3.028), (I-655)+(2.040)+(3.029), (I-655)+(2.040)+(3.030), (I-655)+(2.040)+(3.031), (I-655)+(2.040)+(5.001), (I-655)+(2.040)+(5.002), (I-655)+(2.040)+(5.003), (I-655)+(2.040)+(5.004), (I-655)+(2.040)+(5.005), (I-655)+(2.040)+(5.006), (I-655)+(2.040)+(5.007), (I-655)+(2.040)+(5.008), (I-655)+(2.040)+(5.009), (I-655)+(2.040)+(5.010), (I-655)+(2.040)+(5.011), (I-655)+(2.040)+(5.012), (I-655)+(2.040)+(5.013), (I-655)+(2.040)+(5.014), (I-655)+(2.040)+(5.015), (I-655)+(2.040)+(5.016), (I-655)+(2.040)+(5.017), (I-655)+(2.040)+(5.018), (I-655)+(2.040)+(5.019), (I-655)+(2.040)+(5.020), (I-655)+(2.040)+(5.021), (I-655)+(2.040)+(5.022), (I-655)+(2.040)+(5.023), (I-655)+(2.040)+(6.001), (I-655)+(2.040)+(6.002), (I-655)+(2.040)+(6.003), (I-655)+(2.040)+(6.004), (I-655)+(2.040)+(7.001), (I-655)+(2.040)+(7.002), (I-655)+(2.040)+(7.003), (I-655)+(2.040)+(7.004), (I-655)+(2.040)+(7.005), (I-655)+(2.040)+(7.006), (I-655)+(2.040)+(9.001), (I-655)+(2.040)+(9.002), (I-655)+(2.040)+(9.003), (I-655)+(2.040)+(9.004), (I-655)+(2.040)+(9.005), (I-655)+(2.040)+(9.006), (I-655)+(2.040)+(9.007), (I-655)+(2.040)+(9.008), (I-655)+(2.040)+(9.009), (I-655)+(2.040)+(14.001), (I-655)+(2.040)+(14.002), (I-655)+(2.040)+(15.008), (I-655)+(2.040)+(15.011), (I-655)+(2.040)+(15.012), (I-655)+(2.040)+(15.016), (I-655)+(2.040)+(15.025), (I-655)+(2.040)+(15.027), (I-655)+(2.040)+(15.047), (I-655)+(2.040)+(15.063), (I-655)+(2.040)+(15.064), (I-655)+(2.040)+(16.001), (I-655)+(2.040)+(16.002), (I-655)+(2.040)+(16.003), (I-655)+(2.040)+(16.004), (I-655)+(2.040)+(16.005), (I-655)+(2.040)+(16.006), (I-655)+(2.040)+(16.007), (I-655)+(2.040)+(16.008), (I-655)+(2.040)+(17.001), (I-655)+(2.040)+(17.002), (I-655)+(2.040)+(17.003), (I-655)+(2.040)+(17.004), (I-655)+(2.040)+(17.005), (I-655)+(2.040)+(17.006), (I-655)+(2.040)+(17.007), (I-655)+(2.040)+(17.008), (I-655)+(2.040)+(17.009), (I-655)+(2.040)+(17.010), (I-655)+(2.040)+(17.011), (I-655)+(2.040)+(17.012), (I-655)+(2.040)+(18.001),

(I-655)+(2.041)+(3.001), (I-655)+(2.041)+(3.002), (I-655)+(2.041)+(3.003), (I-655)+(2.041)+(3.004), (I-655)+(2.041)+(3.005), (I-655)+(2.041)+(3.006), (I-655)+(2.041)+(3.007), (I-655)+(2.041)+(3.008), (I-655)+(2.041)+(3.009), (I-655)+(2.041)+(3.010), (I-655)+(2.041)+(3.011), (I-655)+(2.041)+(3.012), (I-655)+(2.041)+(3.013), (I-655)+(2.041)+(3.014), (I-655)+(2.041)+(3.015), (I-655)+(2.041)+(3.016), (I-655)+(2.041)+(3.017), (I-655)+(2.041)+(3.018), (I-655)+(2.041)+(3.019), (I-655)+(2.041)+(3.020), (I-655)+(2.041)+(3.021), (I-655)+(2.041)+(3.022), (I-655)+(2.041)+(3.023), (I-655)+(2.041)+(3.024), (I-655)+(2.041)+(3.025), (I-655)+(2.041)+(3.026), (I-655)+(2.041)+(3.027), (I-655)+(2.041)+(3.028), (I-655)+(2.041)+(3.029), (I-655)+(2.041)+(3.030), (I-655)+(2.041)+(3.031), (I-655)+(2.041)+(5.001), (I-655)+(2.041)+(5.002), (I-655)+(2.041)+(5.003), (I-655)+(2.041)+(5.004), (I-655)+(2.041)+(5.005), (I-655)+(2.041)+(5.006), (I-655)+(2.041)+(5.007), (I-655)+(2.041)+(5.008), (I-655)+(2.041)+(5.009), (I-655)+(2.041)+(5.010), (I-655)+(2.041)+(5.011), (I-655)+(2.041)+(5.012), (I-655)+(2.041)+(5.013), (I-655)+(2.041)+(5.014), (I-655)+(2.041)+(5.015), (I-655)+(2.041)+(5.016), (I-655)+(2.041)+(5.017), (I-655)+(2.041)+(5.018), (I-655)+(2.041)+(5.019), (I-655)+(2.041)+(5.020), (I-655)+(2.041)+(5.021), (I-655)+(2.041)+(5.022), (I-655)+(2.041)+(5.023), (I-655)+(2.041)+(6.001), (I-655)+(2.041)+(6.002), (I-655)+(2.041)+(6.003), (I-655)+(2.041)+(6.004), (I-655)+(2.041)+(7.001), (I-655)+(2.041)+(7.002), (I-655)+(2.041)+(7.003), (I-655)+(2.041)+(7.004), (I-655)+(2.041)+(7.005), (I-655)+(2.041)+(7.006), (I-655)+(2.041)+(9.001), (I-655)+(2.041)+(9.002), (I-655)+(2.041)+(9.003), (I-655)+(2.041)+(9.004), (I-655)+(2.041)+(9.005), (I-655)+(2.041)+(9.006), (I-655)+(2.041)+(9.007), (I-655)+(2.041)+(9.008), (I-655)+(2.041)+(9.009), (I-655)+(2.041)+(14.001), (I-655)+(2.041)+(14.002), (I-655)+(2.041)+(15.008), (I-655)+(2.041)+(15.011), (I-655)+(2.041)+(15.012), (I-655)+(2.041)+(15.016), (I-655)+(2.041)+(15.025), (I-655)+(2.041)+(15.027), (I-655)+(2.041)+(15.047), (I-655)+(2.041)+(15.063), (I-655)+(2.041)+(15.064), (I-655)+(2.041)+(16.001), (I-655)+(2.041)+(16.002), (I-655)+(2.041)+(16.003), (I-655)+(2.041)+(16.004), (I-655)+(2.041)+(16.005), (I-655)+(2.041)+(16.006), (I-655)+(2.041)+(16.007), (I-655)+(2.041)+(16.008), (I-655)+(2.041)+(17.001), (I-655)+(2.041)+(17.002), (I-655)+(2.041)+(17.003), (I-655)+(2.041)+(17.004), (I-655)+(2.041)+(17.005), (I-655)+(2.041)+(17.006), (I-655)+(2.041)+(17.007), (I-655)+(2.041)+(17.008), (I-655)+(2.041)+(17.009), (I-655)+(2.041)+(17.010), (I-655)+(2.041)+(17.011), (I-655)+(2.041)+(17.012), (I-655)+(2.041)+(18.001),

(I-655)+(2.042)+(3.001), (I-655)+(2.042)+(3.002), (I-655)+(2.042)+(3.003), (I-655)+(2.042)+(3.004), (I-655)+(2.042)+(3.005), (I-655)+(2.042)+(3.006), (I-655)+(2.042)+(3.007), (I-655)+(2.042)+(3.008), (I-655)+(2.042)+(3.009), (I-655)+(2.042)+(3.010), (I-655)+(2.042)+(3.011), (I-655)+(2.042)+(3.012), (I-655)+(2.042)+(3.013), (I-655)+(2.042)+(3.014), (I-655)+(2.042)+(3.015), (I-655)+(2.042)+(3.016), (I-655)+(2.042)+(3.017), (I-655)+(2.042)+(3.018), (I-655)+(2.042)+(3.019), (I-655)+(2.042)+(3.020), (I-655)+(2.042)+(3.021), (I-655)+(2.042)+(3.022), (I-655)+(2.042)+(3.023), (I-655)+(2.042)+(3.024), (I-655)+(2.042)+(3.025), (I-655)+(2.042)+(3.026), (I-655)+(2.042)+(3.027), (I-655)+(2.042)+(3.028), (I-655)+(2.042)+(3.029), (I-655)+(2.042)+(3.030), (I-655)+(2.042)+(3.031), (I-655)+(2.042)+(5.001), (I-655)+(2.042)+(5.002), (I-655)+(2.042)+(5.003), (I-655)+(2.042)+(5.004), (I-655)+(2.042)+(5.005), (I-655)+(2.042)+(5.006), (I-655)+(2.042)+(5.007), (I-655)+(2.042)+(5.008), (I-655)+(2.042)+(5.009), (I-655)+(2.042)+(5.010), (I-655)+(2.042)+(5.011), (I-655)+(2.042)+(5.012), (I-655)+(2.042)+(5.013), (I-655)+(2.042)+(5.014), (I-655)+(2.042)+(5.015), (I-655)+(2.042)+(5.016), (I-655)+(2.042)+(5.017), (I-655)+(2.042)+(5.018), (I-655)+(2.042)+(5.019), (I-655)+(2.042)+(5.020), (I-655)+(2.042)+(5.021), (I-655)+(2.042)+(5.022), (I-655)+(2.042)+(5.023), (I-655)+(2.042)+(6.001), (I-655)+(2.042)+(6.002), (I-655)+(2.042)+(6.003), (I-655)+(2.042)+(6.004), (I-655)+(2.042)+(7.001), (I-655)+(2.042)+(7.002), (I-655)+(2.042)+(7.003), (I-655)+(2.042)+(7.004), (I-655)+(2.042)+(7.005), (I-655)+(2.042)+(7.006), (I-655)+(2.042)+(9.001), (I-655)+(2.042)+(9.002), (I-655)+(2.042)+(9.003), (I-655)+(2.042)+(9.004), (I-655)+(2.042)+(9.005), (I-655)+(2.042)+(9.006), (I-655)+(2.042)+(9.007), (I-655)+(2.042)+(9.008), (I-655)+(2.042)+(9.009), (I-655)+(2.042)+(14.001), (I-655)+(2.042)+(14.002), (I-655)+(2.042)+(15.008), (I-655)+(2.042)+(15.011), (I-655)+(2.042)+(15.012), (I-655)+(2.042)+(15.016), (I-655)+(2.042)+(15.025), (I-655)+(2.042)+(15.027), (I-655)+(2.042)+(15.047), (I-655)+(2.042)+(15.063), (I-655)+(2.042)+(15.064), (I-655)+(2.042)+(16.001), (I-655)+(2.042)+(16.002), (I-655)+(2.042)+(16.003), (I-655)+(2.042)+(16.004), (I-655)+(2.042)+(16.005), (I-655)+(2.042)+(16.006), (I-655)+(2.042)+(16.007), (I-655)+(2.042)+(16.008), (I-655)+(2.042)+(17.001), (I-655)+(2.042)+(17.002), (I-655)+(2.042)+(17.003), (I-655)+(2.042)+(17.004), (I-655)+(2.042)+(17.005), (I-655)+(2.042)+(17.006), (I-655)+(2.042)+(17.007), (I-655)+(2.042)+(17.008), (I-655)+(2.042)+(17.009), (I-655)+(2.042)+(17.010), (I-655)+(2.042)+(17.011), (I-655)+(2.042)+(17.012), (I-655)+(2.042)+(18.001),

(I-655)+(2.043)+(3.001), (I-655)+(2.043)+(3.002), (I-655)+(2.043)+(3.003), (I-655)+(2.043)+(3.004), (I-655)+(2.043)+(3.005), (I-655)+(2.043)+(3.006), (I-655)+(2.043)+(3.007), (I-655)+(2.043)+(3.008), (I-655)+(2.043)+(3.009), (I-655)+(2.043)+(3.010), (I-655)+(2.043)+(3.011), (I-655)+(2.043)+(3.012), (I-655)+(2.043)+(3.013), (I-655)+(2.043)+(3.014), (I-655)+(2.043)+(3.015), (I-655)+(2.043)+(3.016), (I-655)+(2.043)+(3.017), (I-655)+(2.043)+(3.018), (I-655)+(2.043)+(3.019), (I-655)+(2.043)+(3.020), (I-655)+(2.043)+(3.021), (I-655)+(2.043)+(3.022), (I-655)+(2.043)+(3.023), (I-655)+(2.043)+(3.024), (I-655)+(2.043)+(3.025), (I-655)+(2.043)+(3.026), (I-655)+(2.043)+(3.027), (I-655)+(2.043)+(3.028), (I-655)+(2.043)+(3.029), (I-655)+(2.043)+(3.030), (I-655)+(2.043)+(3.031), (I-655)+(2.043)+(5.001), (I-655)+(2.043)+(5.002), (I-655)+(2.043)+(5.003), (I-655)+(2.043)+(5.004), (I-655)+(2.043)+(5.005), (I-655)+(2.043)+(5.006), (I-655)+(2.043)+(5.007), (I-655)+(2.043)+(5.008), (I-655)+(2.043)+(5.009), (I-655)+(2.043)+(5.010), (I-655)+(2.043)+(5.011), (I-655)+(2.043)+(5.012), (I-655)+(2.043)+(5.013), (I-655)+(2.043)+(5.014), (I-655)+(2.043)+(5.015), (I-655)+(2.043)+(5.016), (I-655)+(2.043)+(5.017), (I-655)+(2.043)+(5.018), (I-655)+(2.043)+(5.019), (I-655)+(2.043)+(5.020), (I-655)+(2.043)+(5.021), (I-655)+(2.043)+(5.022), (I-655)+(2.043)+(5.023), (I-655)+(2.043)+(6.001), (I-655)+(2.043)+(6.002), (I-655)+(2.043)+(6.003), (I-655)+(2.043)+(6.004), (I-655)+(2.043)+(7.001), (I-655)+(2.043)+(7.002), (I-655)+(2.043)+(7.003), (I-655)+(2.043)+(7.004), (I-655)+(2.043)+(7.005), (I-655)+(2.043)+(7.006), (I-655)+(2.043)+(9.001), (I-655)+(2.043)+(9.002), (I-655)+(2.043)+(9.003), (I-655)+(2.043)+(9.004), (I-655)+(2.043)+(9.005), (I-655)+(2.043)+(9.006), (I-655)+(2.043)+(9.007), (I-655)+(2.043)+(9.008), (I-655)+(2.043)+(9.009), (I-655)+(2.043)+(14.001), (I-655)+(2.043)+(14.002), (I-655)+(2.043)+(15.008), (I-655)+(2.043)+(15.011), (I-655)+(2.043)+(15.012), (I-655)+(2.043)+(15.016), (I-655)+(2.043)+(15.025), (I-655)+(2.043)+(15.027), (I-655)+(2.043)+(15.047), (I-655)+(2.043)+(15.063), (I-655)+(2.043)+(15.064), (I-655)+(2.043)+(16.001), (I-655)+(2.043)+(16.002), (I-655)+(2.043)+(16.003), (I-655)+(2.043)+(16.004), (I-655)+(2.043)+(16.005), (I-655)+(2.043)+(16.006), (I-655)+(2.043)+(16.007), (I-655)+(2.043)+(16.008), (I-655)+(2.043)+(17.001), (I-655)+(2.043)+(17.002), (I-655)+(2.043)+(17.003), (I-655)+(2.043)+(17.004), (I-655)+(2.043)+(17.005), (I-655)+(2.043)+(17.006), (I-655)+(2.043)+(17.007), (I-655)+(2.043)+(17.008), (I-655)+(2.043)+(17.009), (I-655)+(2.043)+(17.010), (I-655)+(2.043)+(17.011), (I-655)+(2.043)+(17.012), (I-655)+(2.043)+(18.001),

(I-655)+(2.044)+(3.001), (I-655)+(2.044)+(3.002), (I-655)+(2.044)+(3.003), (I-655)+(2.044)+(3.004), (I-655)+(2.044)+(3.005), (I-655)+(2.044)+(3.006), (I-655)+(2.044)+(3.007), (I-655)+(2.044)+(3.008), (I-655)+(2.044)+(3.009), (I-655)+(2.044)+(3.010), (I-655)+(2.044)+(3.011), (I-655)+(2.044)+(3.012), (I-655)+(2.044)+(3.013), (I-655)+(2.044)+(3.014), (I-655)+(2.044)+(3.015), (I-655)+(2.044)+(3.016), (I-655)+(2.044)+(3.017), (I-655)+(2.044)+(3.018), (I-655)+(2.044)+(3.019), (I-655)+(2.044)+(3.020), (I-655)+(2.044)+(3.021), (I-655)+(2.044)+(3.022), (I-655)+(2.044)+(3.023), (I-655)+(2.044)+(3.024), (I-655)+(2.044)+(3.025), (I-655)+(2.044)+(3.026), (I-655)+(2.044)+(3.027), (I-655)+(2.044)+(3.028), (I-655)+(2.044)+(3.029), (I-655)+(2.044)+(3.030), (I-655)+(2.044)+(3.031), (I-655)+(2.044)+(5.001), (I-655)+(2.044)+(5.002), (I-655)+(2.044)+(5.003), (I-655)+(2.044)+(5.004), (I-655)+(2.044)+(5.005), (I-655)+(2.044)+(5.006), (I-655)+(2.044)+(5.007), (I-655)+(2.044)+(5.008), (I-655)+(2.044)+(5.009), (I-655)+(2.044)+(5.010), (I-655)+(2.044)+(5.011), (I-655)+(2.044)+(5.012), (I-655)+(2.044)+(5.013), (I-655)+(2.044)+(5.014), (I-655)+(2.044)+(5.015), (I-655)+(2.044)+(5.016), (I-655)+(2.044)+(5.017), (I-655)+(2.044)+(5.018), (I-655)+(2.044)+(5.019), (I-655)+(2.044)+(5.020), (I-655)+(2.044)+(5.021), (I-655)+(2.044)+(5.022), (I-655)+(2.044)+(5.023), (I-655)+(2.044)+(6.001), (I-655)+(2.044)+(6.002), (I-655)+(2.044)+(6.003), (I-655)+(2.044)+(6.004), (I-655)+(2.044)+(7.001), (I-655)+(2.044)+(7.002), (I-655)+(2.044)+(7.003), (I-655)+(2.044)+(7.004), (I-655)+(2.044)+(7.005), (I-655)+(2.044)+(7.006), (I-655)+(2.044)+(9.001), (I-655)+(2.044)+(9.002), (I-655)+(2.044)+(9.003), (I-655)+(2.044)+(9.004), (I-655)+(2.044)+(9.005), (I-655)+(2.044)+(9.006), (I-655)+(2.044)+(9.007), (I-655)+(2.044)+(9.008), (I-655)+(2.044)+(9.009), (I-655)+(2.044)+(14.001), (I-655)+(2.044)+(14.002), (I-655)+(2.044)+(15.008), (I-655)+(2.044)+(15.011), (I-655)+(2.044)+(15.012), (I-655)+(2.044)+(15.016), (I-655)+(2.044)+(15.025), (I-655)+(2.044)+(15.027), (I-655)+(2.044)+(15.047), (I-655)+(2.044)+(15.063), (I-655)+(2.044)+(15.064), (I-655)+(2.044)+(16.001), (I-655)+(2.044)+(16.002), (I-655)+(2.044)+(16.003), (I-655)+(2.044)+(16.004), (I-655)+(2.044)+(16.005), (I-655)+(2.044)+(16.006), (I-655)+(2.044)+(16.007), (I-655)+(2.044)+(16.008), (I-655)+(2.044)+(17.001), (I-655)+(2.044)+(17.002), (I-655)+(2.044)+(17.003), (I-655)+(2.044)+(17.004), (I-655)+(2.044)+(17.005), (I-655)+(2.044)+(17.006), (I-655)+(2.044)+(17.007), (I-655)+(2.044)+(17.008), (I-655)+(2.044)+(17.009), (I-655)+(2.044)+(17.010), (I-655)+(2.044)+(17.011), (I-655)+(2.044)+(17.012), (I-655)+(2.044)+(18.001),

(I-655)+(2.045)+(3.001), (I-655)+(2.045)+(3.002), (I-655)+(2.045)+(3.003), (I-655)+(2.045)+(3.004), (I-655)+(2.045)+(3.005), (I-655)+(2.045)+(3.006), (I-655)+(2.045)+(3.007), (I-655)+(2.045)+(3.008), (I-655)+(2.045)+(3.009), (I-655)+(2.045)+(3.010), (I-655)+(2.045)+(3.011), (I-655)+(2.045)+(3.012), (I-655)+(2.045)+(3.013), (I-655)+(2.045)+(3.014), (I-655)+(2.045)+(3.015), (I-655)+(2.045)+(3.016), (I-655)+(2.045)+(3.017), (I-655)+(2.045)+(3.018), (I-655)+(2.045)+(3.019), (I-655)+(2.045)+(3.020), (I-655)+(2.045)+(3.021), (I-655)+(2.045)+(3.022), (I-655)+(2.045)+(3.023), (I-655)+(2.045)+(3.024), (I-655)+(2.045)+(3.025), (I-655)+(2.045)+(3.026), (I-655)+(2.045)+(3.027), (I-655)+(2.045)+(3.028), (I-655)+(2.045)+(3.029), (I-655)+(2.045)+(3.030), (I-655)+(2.045)+(3.031), (I-655)+(2.045)+(5.001), (I-655)+(2.045)+(5.002), (I-655)+(2.045)+(5.003), (I-655)+(2.045)+(5.004), (I-655)+(2.045)+(5.005), (I-655)+(2.045)+(5.006), (I-655)+(2.045)+(5.007), (I-655)+(2.045)+(5.008), (I-655)+(2.045)+(5.009), (I-655)+(2.045)+(5.010), (I-655)+(2.045)+(5.011), (I-655)+(2.045)+(5.012), (I-655)+(2.045)+(5.013), (I-655)+(2.045)+(5.014), (I-655)+(2.045)+(5.015), (I-655)+(2.045)+(5.016), (I-655)+(2.045)+(5.017), (I-655)+(2.045)+(5.018), (I-655)+(2.045)+(5.019), (I-655)+(2.045)+(5.020), (I-655)+(2.045)+(5.021), (I-655)+(2.045)+(5.022), (I-655)+(2.045)+(5.023), (I-655)+(2.045)+(6.001), (I-655)+(2.045)+(6.002), (I-655)+(2.045)+(6.003), (I-655)+(2.045)+(6.004), (I-655)+(2.045)+(7.001), (I-655)+(2.045)+(7.002), (I-655)+(2.045)+(7.003), (I-655)+(2.045)+(7.004), (I-655)+(2.045)+(7.005), (I-655)+(2.045)+(7.006), (I-655)+(2.045)+(9.001), (I-655)+(2.045)+(9.002), (I-655)+(2.045)+(9.003), (I-655)+(2.045)+(9.004), (I-655)+(2.045)+(9.005), (I-655)+(2.045)+(9.006), (I-655)+(2.045)+(9.007), (I-655)+(2.045)+(9.008), (I-655)+(2.045)+(9.009), (I-655)+(2.045)+(14.001), (I-655)+(2.045)+(14.002), (I-655)+(2.045)+(15.008), (I-655)+(2.045)+(15.011), (I-655)+(2.045)+(15.012), (I-655)+(2.045)+(15.016), (I-655)+(2.045)+(15.025), (I-655)+(2.045)+(15.027), (I-655)+(2.045)+(15.047), (I-655)+(2.045)+(15.063), (I-655)+(2.045)+(15.064), (I-655)+(2.045)+(16.001), (I-655)+(2.045)+(16.002), (I-655)+(2.045)+(16.003), (I-655)+(2.045)+(16.004), (I-655)+(2.045)+(16.005), (I-655)+(2.045)+(16.006), (I-655)+(2.045)+(16.007), (I-655)+(2.045)+(16.008), (I-655)+(2.045)+(17.001), (I-655)+(2.045)+(17.002), (I-655)+(2.045)+(17.003), (I-655)+(2.045)+(17.004), (I-655)+(2.045)+(17.005), (I-655)+(2.045)+(17.006), (I-655)+(2.045)+(17.007), (I-655)+(2.045)+(17.008), (I-655)+(2.045)+(17.009), (I-655)+(2.045)+(17.010), (I-655)+(2.045)+(17.011), (I-655)+(2.045)+(17.012), (I-655)+(2.045)+(18.001),

(I-655)+(2.046)+(3.001), (I-655)+(2.046)+(3.002), (I-655)+(2.046)+(3.003), (I-655)+(2.046)+(3.004), (I-655)+(2.046)+(3.005), (I-655)+(2.046)+(3.006), (I-655)+(2.046)+(3.007), (I-655)+(2.046)+(3.008), (I-655)+(2.046)+(3.009), (I-655)+(2.046)+(3.010), (I-655)+(2.046)+(3.011), (I-655)+(2.046)+(3.012), (I-655)+(2.046)+(3.013), (I-655)+(2.046)+(3.014), (I-655)+(2.046)+(3.015), (I-655)+(2.046)+(3.016), (I-655)+(2.046)+(3.017), (I-655)+(2.046)+(3.018), (I-655)+(2.046)+(3.019), (I-655)+(2.046)+(3.020), (I-655)+(2.046)+(3.021), (I-655)+(2.046)+(3.022), (I-655)+(2.046)+(3.023), (I-655)+(2.046)+(3.024), (I-655)+(2.046)+(3.025), (I-655)+(2.046)+(3.026), (I-655)+(2.046)+(3.027), (I-655)+(2.046)+(3.028), (I-655)+(2.046)+(3.029), (I-655)+(2.046)+(3.030), (I-655)+(2.046)+(3.031), (I-655)+(2.046)+(5.001), (I-655)+(2.046)+(5.002), (I-655)+(2.046)+(5.003), (I-655)+(2.046)+(5.004), (I-655)+(2.046)+(5.005), (I-655)+(2.046)+(5.006), (I-655)+(2.046)+(5.007), (I-655)+(2.046)+(5.008), (I-655)+(2.046)+(5.009), (I-655)+(2.046)+(5.010), (I-655)+(2.046)+(5.011), (I-655)+(2.046)+(5.012), (I-655)+(2.046)+(5.013), (I-655)+(2.046)+(5.014), (I-655)+(2.046)+(5.015), (I-655)+(2.046)+(5.016), (I-655)+(2.046)+(5.017), (I-655)+(2.046)+(5.018), (I-655)+(2.046)+(5.019), (I-655)+(2.046)+(5.020), (I-655)+(2.046)+(5.021), (I-655)+(2.046)+(5.022), (I-655)+(2.046)+(5.023), (I-655)+(2.046)+(6.001), (I-655)+(2.046)+(6.002), (I-655)+(2.046)+(6.003), (I-655)+(2.046)+(6.004), (I-655)+(2.046)+(7.001), (I-655)+(2.046)+(7.002), (I-655)+(2.046)+(7.003), (I-655)+(2.046)+(7.004), (I-655)+(2.046)+(7.005), (I-655)+(2.046)+(7.006), (I-655)+(2.046)+(9.001), (I-655)+(2.046)+(9.002), (I-655)+(2.046)+(9.003), (I-655)+(2.046)+(9.004), (I-655)+(2.046)+(9.005), (I-655)+(2.046)+(9.006), (I-655)+(2.046)+(9.007), (I-655)+(2.046)+(9.008), (I-655)+(2.046)+(9.009), (I-655)+(2.046)+(14.001), (I-655)+(2.046)+(14.002), (I-655)+(2.046)+(15.008), (I-655)+(2.046)+(15.011), (I-655)+(2.046)+(15.012), (I-655)+(2.046)+(15.016), (I-655)+(2.046)+(15.025), (I-655)+(2.046)+(15.027), (I-655)+(2.046)+(15.047), (I-655)+(2.046)+(15.063), (I-655)+(2.046)+(15.064), (I-655)+(2.046)+(16.001), (I-655)+(2.046)+(16.002), (I-655)+(2.046)+(16.003), (I-655)+(2.046)+(16.004), (I-655)+(2.046)+(16.005), (I-655)+(2.046)+(16.006), (I-655)+(2.046)+(16.007), (I-655)+(2.046)+(16.008), (I-655)+(2.046)+(17.001), (I-655)+(2.046)+(17.002), (I-655)+(2.046)+(17.003), (I-655)+(2.046)+(17.004), (I-655)+(2.046)+(17.005), (I-655)+(2.046)+(17.006), (I-655)+(2.046)+(17.007), (I-655)+(2.046)+(17.008), (I-655)+(2.046)+(17.009), (I-655)+(2.046)+(17.010), (I-655)+(2.046)+(17.011), (I-655)+(2.046)+(17.012), (I-655)+(2.046)+(18.001),

(I-655)+(2.047)+(3.001), (I-655)+(2.047)+(3.002), (I-655)+(2.047)+(3.003), (I-655)+(2.047)+(3.004), (I-655)+(2.047)+(3.005), (I-655)+(2.047)+(3.006), (I-655)+(2.047)+(3.007), (I-655)+(2.047)+(3.008), (I-655)+(2.047)+(3.009), (I-655)+(2.047)+(3.010), (I-655)+(2.047)+(3.011), (I-655)+(2.047)+(3.012), (I-655)+(2.047)+(3.013), (I-655)+(2.047)+(3.014), (I-655)+(2.047)+(3.015), (I-655)+(2.047)+(3.016), (I-655)+(2.047)+(3.017), (I-655)+(2.047)+(3.018), (I-655)+(2.047)+(3.019), (I-655)+(2.047)+(3.020), (I-655)+(2.047)+(3.021), (I-655)+(2.047)+(3.022), (I-655)+(2.047)+(3.023), (I-655)+(2.047)+(3.024), (I-655)+(2.047)+(3.025), (I-655)+(2.047)+(3.026), (I-655)+(2.047)+(3.027), (I-655)+(2.047)+(3.028), (I-655)+(2.047)+(3.029), (I-655)+(2.047)+(3.030), (I-655)+(2.047)+(3.031), (I-655)+(2.047)+(5.001), (I-655)+(2.047)+(5.002), (I-655)+(2.047)+(5.003), (I-655)+(2.047)+(5.004), (I-655)+(2.047)+(5.005), (I-655)+(2.047)+(5.006), (I-655)+(2.047)+(5.007), (I-655)+(2.047)+(5.008), (I-655)+(2.047)+(5.009), (I-655)+(2.047)+(5.010), (I-655)+(2.047)+(5.011), (I-655)+(2.047)+(5.012), (I-655)+(2.047)+(5.013), (I-655)+(2.047)+(5.014), (I-655)+(2.047)+(5.015), (I-655)+(2.047)+(5.016), (I-655)+(2.047)+(5.017), (I-655)+(2.047)+(5.018), (I-655)+(2.047)+(5.019), (I-655)+(2.047)+(5.020), (I-655)+(2.047)+(5.021), (I-655)+(2.047)+(5.022), (I-655)+(2.047)+(5.023), (I-655)+(2.047)+(6.001), (I-655)+(2.047)+(6.002), (I-655)+(2.047)+(6.003), (I-655)+(2.047)+(6.004), (I-655)+(2.047)+(7.001), (I-655)+(2.047)+(7.002), (I-655)+(2.047)+(7.003), (I-655)+(2.047)+(7.004), (I-655)+(2.047)+(7.005), (I-655)+(2.047)+(7.006), (I-655)+(2.047)+(9.001), (I-655)+(2.047)+(9.002), (I-655)+(2.047)+(9.003), (I-655)+(2.047)+(9.004), (I-655)+(2.047)+(9.005), (I-655)+(2.047)+(9.006), (I-655)+(2.047)+(9.007), (I-655)+(2.047)+(9.008), (I-655)+(2.047)+(9.009), (I-655)+(2.047)+(14.001), (I-655)+(2.047)+(14.002), (I-655)+(2.047)+(15.008), (I-655)+(2.047)+(15.011), (I-655)+(2.047)+(15.012), (I-655)+(2.047)+(15.016), (I-655)+(2.047)+(15.025), (I-655)+(2.047)+(15.027), (I-655)+(2.047)+(15.047), (I-655)+(2.047)+(15.063), (I-655)+(2.047)+(15.064), (I-655)+(2.047)+(16.001), (I-655)+(2.047)+(16.002), (I-655)+(2.047)+(16.003), (I-655)+(2.047)+(16.004), (I-655)+(2.047)+(16.005), (I-655)+(2.047)+(16.006), (I-655)+(2.047)+(16.007), (I-655)+(2.047)+(16.008), (I-655)+(2.047)+(17.001), (I-655)+(2.047)+(17.002), (I-655)+(2.047)+(17.003), (I-655)+(2.047)+(17.004), (I-655)+(2.047)+(17.005), (I-655)+(2.047)+(17.006), (I-655)+(2.047)+(17.007), (I-655)+(2.047)+(17.008), (I-655)+(2.047)+(17.009), (I-655)+(2.047)+(17.010), (I-655)+(2.047)+(17.011), (I-655)+(2.047)+(17.012), (I-655)+(2.047)+(18.001),

(I-655)+(2.048)+(3.001), (I-655)+(2.048)+(3.002), (I-655)+(2.048)+(3.003), (I-655)+(2.048)+(3.004), (I-655)+(2.048)+(3.005), (I-655)+(2.048)+(3.006), (I-655)+(2.048)+(3.007), (I-655)+(2.048)+(3.008), (I-655)+(2.048)+(3.009), (I-655)+(2.048)+(3.010), (I-655)+(2.048)+(3.011), (I-655)+(2.048)+(3.012), (I-655)+(2.048)+(3.013), (I-655)+(2.048)+(3.014), (I-655)+(2.048)+(3.015), (I-655)+(2.048)+(3.016), (I-655)+(2.048)+(3.017), (I-655)+(2.048)+(3.018), (I-655)+(2.048)+(3.019), (I-655)+(2.048)+(3.020), (I-655)+(2.048)+(3.021), (I-655)+(2.048)+(3.022), (I-655)+(2.048)+(3.023), (I-655)+(2.048)+(3.024), (I-655)+(2.048)+(3.025), (I-655)+(2.048)+(3.026), (I-655)+(2.048)+(3.027), (I-655)+(2.048)+(3.028), (I-655)+(2.048)+(3.029), (I-655)+(2.048)+(3.030), (I-655)+(2.048)+(3.031), (I-655)+(2.048)+(5.001), (I-655)+(2.048)+(5.002), (I-655)+(2.048)+(5.003), (I-655)+(2.048)+(5.004), (I-655)+(2.048)+(5.005), (I-655)+(2.048)+(5.006), (I-655)+(2.048)+(5.007), (I-655)+(2.048)+(5.008), (I-655)+(2.048)+(5.009), (I-655)+(2.048)+(5.010), (I-655)+(2.048)+(5.011), (I-655)+(2.048)+(5.012), (I-655)+(2.048)+(5.013), (I-655)+(2.048)+(5.014), (I-655)+(2.048)+(5.015), (I-655)+(2.048)+(5.016), (I-655)+(2.048)+(5.017), (I-655)+(2.048)+(5.018), (I-655)+(2.048)+(5.019), (I-655)+(2.048)+(5.020), (I-655)+(2.048)+(5.021), (I-655)+(2.048)+(5.022), (I-655)+(2.048)+(5.023), (I-655)+(2.048)+(6.001), (I-655)+(2.048)+(6.002), (I-655)+(2.048)+(6.003), (I-655)+(2.048)+(6.004), (I-655)+(2.048)+(7.001), (I-655)+(2.048)+(7.002), (I-655)+(2.048)+(7.003), (I-655)+(2.048)+(7.004), (I-655)+(2.048)+(7.005), (I-655)+(2.048)+(7.006), (I-655)+(2.048)+(9.001), (I-655)+(2.048)+(9.002), (I-655)+(2.048)+(9.003), (I-655)+(2.048)+(9.004), (I-655)+(2.048)+(9.005), (I-655)+(2.048)+(9.006), (I-655)+(2.048)+(9.007), (I-655)+(2.048)+(9.008), (I-655)+(2.048)+(9.009), (I-655)+(2.048)+(14.001), (I-655)+(2.048)+(14.002), (I-655)+(2.048)+(15.008), (I-655)+(2.048)+(15.011), (I-655)+(2.048)+(15.012), (I-655)+(2.048)+(15.016), (I-655)+(2.048)+(15.025), (I-655)+(2.048)+(15.027), (I-655)+(2.048)+(15.047), (I-655)+(2.048)+(15.063), (I-655)+(2.048)+(15.064), (I-655)+(2.048)+(16.001), (I-655)+(2.048)+(16.002), (I-655)+(2.048)+(16.003), (I-655)+(2.048)+(16.004), (I-655)+(2.048)+(16.005), (I-655)+(2.048)+(16.006), (I-655)+(2.048)+(16.007), (I-655)+(2.048)+(16.008), (I-655)+(2.048)+(17.001), (I-655)+(2.048)+(17.002), (I-655)+(2.048)+(17.003), (I-655)+(2.048)+(17.004), (I-655)+(2.048)+(17.005), (I-655)+(2.048)+(17.006), (I-655)+(2.048)+(17.007), (I-655)+(2.048)+(17.008), (I-655)+(2.048)+(17.009), (I-655)+(2.048)+(17.010), (I-655)+(2.048)+(17.011), (I-655)+(2.048)+(17.012), (I-655)+(2.048)+(18.001),

(I-655)+(2.049)+(3.001), (I-655)+(2.049)+(3.002), (I-655)+(2.049)+(3.003), (I-655)+(2.049)+(3.004), (I-655)+(2.049)+(3.005), (I-655)+(2.049)+(3.006), (I-655)+(2.049)+(3.007), (I-655)+(2.049)+(3.008), (I-655)+(2.049)+(3.009), (I-655)+(2.049)+(3.010), (I-655)+(2.049)+(3.011), (I-655)+(2.049)+(3.012), (I-655)+(2.049)+(3.013), (I-655)+(2.049)+(3.014), (I-655)+(2.049)+(3.015), (I-655)+(2.049)+(3.016), (I-655)+(2.049)+(3.017), (I-655)+(2.049)+(3.018), (I-655)+(2.049)+(3.019), (I-655)+(2.049)+(3.020), (I-655)+(2.049)+(3.021), (I-655)+(2.049)+(3.022), (I-655)+(2.049)+(3.023), (I-655)+(2.049)+(3.024), (I-655)+(2.049)+(3.025), (I-655)+(2.049)+(3.026), (I-655)+(2.049)+(3.027), (I-655)+(2.049)+(3.028), (I-655)+(2.049)+(3.029), (I-655)+(2.049)+(3.030), (I-655)+(2.049)+(3.031), (I-655)+(2.049)+(5.001), (I-655)+(2.049)+(5.002), (I-655)+(2.049)+(5.003), (I-655)+(2.049)+(5.004), (I-655)+(2.049)+(5.005), (I-655)+(2.049)+(5.006), (I-655)+(2.049)+(5.007), (I-655)+(2.049)+(5.008), (I-655)+(2.049)+(5.009), (I-655)+(2.049)+(5.010), (I-655)+(2.049)+(5.011), (I-655)+(2.049)+(5.012), (I-655)+(2.049)+(5.013), (I-655)+(2.049)+(5.014), (I-655)+(2.049)+(5.015), (I-655)+(2.049)+(5.016), (I-655)+(2.049)+(5.017), (I-655)+(2.049)+(5.018), (I-655)+(2.049)+(5.019), (I-655)+(2.049)+(5.020), (I-655)+(2.049)+(5.021), (I-655)+(2.049)+(5.022), (I-655)+(2.049)+(5.023), (I-655)+(2.049)+(6.001), (I-655)+(2.049)+(6.002), (I-655)+(2.049)+(6.003), (I-655)+(2.049)+(6.004), (I-655)+(2.049)+(7.001), (I-655)+(2.049)+(7.002), (I-655)+(2.049)+(7.003), (I-655)+(2.049)+(7.004), (I-655)+(2.049)+(7.005), (I-655)+(2.049)+(7.006), (I-655)+(2.049)+(9.001), (I-655)+(2.049)+(9.002), (I-655)+(2.049)+(9.003), (I-655)+(2.049)+(9.004), (I-655)+(2.049)+(9.005), (I-655)+(2.049)+(9.006), (I-655)+(2.049)+(9.007), (I-655)+(2.049)+(9.008), (I-655)+(2.049)+(9.009), (I-655)+(2.049)+(14.001), (I-655)+(2.049)+(14.002), (I-655)+(2.049)+(15.008), (I-655)+(2.049)+(15.011), (I-655)+(2.049)+(15.012), (I-655)+(2.049)+(15.016), (I-655)+(2.049)+(15.025), (I-655)+(2.049)+(15.027), (I-655)+(2.049)+(15.047), (I-655)+(2.049)+(15.063), (I-655)+(2.049)+(15.064), (I-655)+(2.049)+(16.001), (I-655)+(2.049)+(16.002), (I-655)+(2.049)+(16.003), (I-655)+(2.049)+(16.004), (I-655)+(2.049)+(16.005), (I-655)+(2.049)+(16.006), (I-655)+(2.049)+(16.007), (I-655)+(2.049)+(16.008), (I-655)+(2.049)+(17.001), (I-655)+(2.049)+(17.002), (I-655)+(2.049)+(17.003), (I-655)+(2.049)+(17.004), (I-655)+(2.049)+(17.005), (I-655)+(2.049)+(17.006), (I-655)+(2.049)+(17.007), (I-655)+(2.049)+(17.008), (I-655)+(2.049)+(17.009), (I-655)+(2.049)+(17.010), (I-655)+(2.049)+(17.011), (I-655)+(2.049)+(17.012), (I-655)+(2.049)+(18.001),

(I-655)+(2.050)+(3.001), (I-655)+(2.050)+(3.002), (I-655)+(2.050)+(3.003), (I-655)+(2.050)+(3.004), (I-655)+(2.050)+(3.005), (I-655)+(2.050)+(3.006), (I-655)+(2.050)+(3.007), (I-655)+(2.050)+(3.008), (I-655)+(2.050)+(3.009), (I-655)+(2.050)+(3.010), (I-655)+(2.050)+(3.011), (I-655)+(2.050)+(3.012), (I-655)+(2.050)+(3.013), (I-655)+(2.050)+(3.014), (I-655)+(2.050)+(3.015), (I-655)+(2.050)+(3.016), (I-655)+(2.050)+(3.017), (I-655)+(2.050)+(3.018), (I-655)+(2.050)+(3.019), (I-655)+(2.050)+(3.020), (I-655)+(2.050)+(3.021), (I-655)+(2.050)+(3.022), (I-655)+(2.050)+(3.023), (I-655)+(2.050)+(3.024), (I-655)+(2.050)+(3.025), (I-655)+(2.050)+(3.026), (I-655)+(2.050)+(3.027), (I-655)+(2.050)+(3.028), (I-655)+(2.050)+(3.029), (I-655)+(2.050)+(3.030), (I-655)+(2.050)+(3.031), (I-655)+(2.050)+(5.001), (I-655)+(2.050)+(5.002), (I-655)+(2.050)+(5.003), (I-655)+(2.050)+(5.004), (I-655)+(2.050)+(5.005), (I-655)+(2.050)+(5.006), (I-655)+(2.050)+(5.007), (I-655)+(2.050)+(5.008), (I-655)+(2.050)+(5.009), (I-655)+(2.050)+(5.010), (I-655)+(2.050)+(5.011), (I-655)+(2.050)+(5.012), (I-655)+(2.050)+(5.013), (I-655)+(2.050)+(5.014), (I-655)+(2.050)+(5.015), (I-655)+(2.050)+(5.016), (I-655)+(2.050)+(5.017), (I-655)+(2.050)+(5.018), (I-655)+(2.050)+(5.019), (I-655)+(2.050)+(5.020), (I-655)+(2.050)+(5.021), (I-655)+(2.050)+(5.022), (I-655)+(2.050)+(5.023), (I-655)+(2.050)+(6.001), (I-655)+(2.050)+(6.002), (I-655)+(2.050)+(6.003), (I-655)+(2.050)+(6.004), (I-655)+(2.050)+(7.001), (I-655)+(2.050)+(7.002), (I-655)+(2.050)+(7.003), (I-655)+(2.050)+(7.004), (I-655)+(2.050)+(7.005), (I-655)+(2.050)+(7.006), (I-655)+(2.050)+(9.001), (I-655)+(2.050)+(9.002), (I-655)+(2.050)+(9.003), (I-655)+(2.050)+(9.004), (I-655)+(2.050)+(9.005), (I-655)+(2.050)+(9.006), (I-655)+(2.050)+(9.007), (I-655)+(2.050)+(9.008), (I-655)+(2.050)+(9.009), (I-655)+(2.050)+(14.001), (I-655)+(2.050)+(14.002), (I-655)+(2.050)+(15.008), (I-655)+(2.050)+(15.011), (I-655)+(2.050)+(15.012), (I-655)+(2.050)+(15.016), (I-655)+(2.050)+(15.025), (I-655)+(2.050)+(15.027), (I-655)+(2.050)+(15.047), (I-655)+(2.050)+(15.063), (I-655)+(2.050)+(15.064), (I-655)+(2.050)+(16.001), (I-655)+(2.050)+(16.002), (I-655)+(2.050)+(16.003), (I-655)+(2.050)+(16.004), (I-655)+(2.050)+(16.005), (I-655)+(2.050)+(16.006), (I-655)+(2.050)+(16.007), (I-655)+(2.050)+(16.008), (I-655)+(2.050)+(17.001), (I-655)+(2.050)+(17.002), (I-655)+(2.050)+(17.003), (I-655)+(2.050)+(17.004), (I-655)+(2.050)+(17.005), (I-655)+(2.050)+(17.006), (I-655)+(2.050)+(17.007), (I-655)+(2.050)+(17.008), (I-655)+(2.050)+(17.009), (I-655)+(2.050)+(17.010), (I-655)+(2.050)+(17.011), (I-655)+(2.050)+(17.012), (I-655)+(2.050)+(18.001),

(I-655)+(2.051)+(3.001), (I-655)+(2.051)+(3.002), (I-655)+(2.051)+(3.003), (I-655)+(2.051)+(3.004), (I-655)+(2.051)+(3.005), (I-655)+(2.051)+(3.006), (I-655)+(2.051)+(3.007), (I-655)+(2.051)+(3.008), (I-655)+(2.051)+(3.009), (I-655)+(2.051)+(3.010), (I-655)+(2.051)+(3.011), (I-655)+(2.051)+(3.012), (I-655)+(2.051)+(3.013), (I-655)+(2.051)+(3.014), (I-655)+(2.051)+(3.015), (I-655)+(2.051)+(3.016), (I-655)+(2.051)+(3.017), (I-655)+(2.051)+(3.018), (I-655)+(2.051)+(3.019), (I-655)+(2.051)+(3.020), (I-655)+(2.051)+(3.021), (I-655)+(2.051)+(3.022), (I-655)+(2.051)+(3.023), (I-655)+(2.051)+(3.024), (I-655)+(2.051)+(3.025), (I-655)+(2.051)+(3.026), (I-655)+(2.051)+(3.027), (I-655)+(2.051)+(3.028), (I-655)+(2.051)+(3.029), (I-655)+(2.051)+(3.030), (I-655)+(2.051)+(3.031), (I-655)+(2.051)+(5.001), (I-655)+(2.051)+(5.002), (I-655)+(2.051)+(5.003), (I-655)+(2.051)+(5.004), (I-655)+(2.051)+(5.005), (I-655)+(2.051)+(5.006), (I-655)+(2.051)+(5.007), (I-655)+(2.051)+(5.008), (I-655)+(2.051)+(5.009), (I-655)+(2.051)+(5.010), (I-655)+(2.051)+(5.011), (I-655)+(2.051)+(5.012), (I-655)+(2.051)+(5.013), (I-655)+(2.051)+(5.014), (I-655)+(2.051)+(5.015), (I-655)+(2.051)+(5.016), (I-655)+(2.051)+(5.017), (I-655)+(2.051)+(5.018), (I-655)+(2.051)+(5.019), (I-655)+(2.051)+(5.020), (I-655)+(2.051)+(5.021), (I-655)+(2.051)+(5.022), (I-655)+(2.051)+(5.023), (I-655)+(2.051)+(6.001), (I-655)+(2.051)+(6.002), (I-655)+(2.051)+(6.003), (I-655)+(2.051)+(6.004), (I-655)+(2.051)+(7.001), (I-655)+(2.051)+(7.002), (I-655)+(2.051)+(7.003), (I-655)+(2.051)+(7.004), (I-655)+(2.051)+(7.005), (I-655)+(2.051)+(7.006), (I-655)+(2.051)+(9.001), (I-655)+(2.051)+(9.002), (I-655)+(2.051)+(9.003), (I-655)+(2.051)+(9.004), (I-655)+(2.051)+(9.005), (I-655)+(2.051)+(9.006), (I-655)+(2.051)+(9.007), (I-655)+(2.051)+(9.008), (I-655)+(2.051)+(9.009), (I-655)+(2.051)+(14.001), (I-655)+(2.051)+(14.002), (I-655)+(2.051)+(15.008), (I-655)+(2.051)+(15.011), (I-655)+(2.051)+(15.012), (I-655)+(2.051)+(15.016), (I-655)+(2.051)+(15.025), (I-655)+(2.051)+(15.027), (I-655)+(2.051)+(15.047), (I-655)+(2.051)+(15.063), (I-655)+(2.051)+(15.064), (I-655)+(2.051)+(16.001), (I-655)+(2.051)+(16.002), (I-655)+(2.051)+(16.003), (I-655)+(2.051)+(16.004), (I-655)+(2.051)+(16.005), (I-655)+(2.051)+(16.006), (I-655)+(2.051)+(16.007), (I-655)+(2.051)+(16.008), (I-655)+(2.051)+(17.001), (I-655)+(2.051)+(17.002), (I-655)+(2.051)+(17.003), (I-655)+(2.051)+(17.004), (I-655)+(2.051)+(17.005), (I-655)+(2.051)+(17.006), (I-655)+(2.051)+(17.007), (I-655)+(2.051)+(17.008), (I-655)+(2.051)+(17.009), (I-655)+(2.051)+(17.010), (I-655)+(2.051)+(17.011), (I-655)+(2.051)+(17.012), (I-655)+(2.051)+(18.001),

(I-655)+(2.052)+(3.001), (I-655)+(2.052)+(3.002), (I-655)+(2.052)+(3.003), (I-655)+(2.052)+(3.004), (I-655)+(2.052)+(3.005), (I-655)+(2.052)+(3.006), (I-655)+(2.052)+(3.007), (I-655)+(2.052)+(3.008), (I-655)+(2.052)+(3.009), (I-655)+(2.052)+(3.010), (I-655)+(2.052)+(3.011), (I-655)+(2.052)+(3.012), (I-655)+(2.052)+(3.013), (I-655)+(2.052)+(3.014), (I-655)+(2.052)+(3.015), (I-655)+(2.052)+(3.016), (I-655)+(2.052)+(3.017), (I-655)+(2.052)+(3.018), (I-655)+(2.052)+(3.019), (I-655)+(2.052)+(3.020), (I-655)+(2.052)+(3.021), (I-655)+(2.052)+(3.022), (I-655)+(2.052)+(3.023), (I-655)+(2.052)+(3.024), (I-655)+(2.052)+(3.025), (I-655)+(2.052)+(3.026), (I-655)+(2.052)+(3.027), (I-655)+(2.052)+(3.028), (I-655)+(2.052)+(3.029), (I-655)+(2.052)+(3.030), (I-655)+(2.052)+(3.031), (I-655)+(2.052)+(5.001), (I-655)+(2.052)+(5.002), (I-655)+(2.052)+(5.003), (I-655)+(2.052)+(5.004), (I-655)+(2.052)+(5.005), (I-655)+(2.052)+(5.006), (I-655)+(2.052)+(5.007), (I-655)+(2.052)+(5.008), (I-655)+(2.052)+(5.009), (I-655)+(2.052)+(5.010), (I-655)+(2.052)+(5.011), (I-655)+(2.052)+(5.012), (I-655)+(2.052)+(5.013), (I-655)+(2.052)+(5.014), (I-655)+(2.052)+(5.015), (I-655)+(2.052)+(5.016), (I-655)+(2.052)+(5.017), (I-655)+(2.052)+(5.018), (I-655)+(2.052)+(5.019), (I-655)+(2.052)+(5.020), (I-655)+(2.052)+(5.021), (I-655)+(2.052)+(5.022), (I-655)+(2.052)+(5.023), (I-655)+(2.052)+(6.001), (I-655)+(2.052)+(6.002), (I-655)+(2.052)+(6.003), (I-655)+(2.052)+(6.004), (I-655)+(2.052)+(7.001), (I-655)+(2.052)+(7.002), (I-655)+(2.052)+(7.003), (I-655)+(2.052)+(7.004), (I-655)+(2.052)+(7.005), (I-655)+(2.052)+(7.006), (I-655)+(2.052)+(9.001), (I-655)+(2.052)+(9.002), (I-655)+(2.052)+(9.003), (I-655)+(2.052)+(9.004), (I-655)+(2.052)+(9.005), (I-655)+(2.052)+(9.006), (I-655)+(2.052)+(9.007), (I-655)+(2.052)+(9.008), (I-655)+(2.052)+(9.009), (I-655)+(2.052)+(14.001), (I-655)+(2.052)+(14.002), (I-655)+(2.052)+(15.008), (I-655)+(2.052)+(15.011), (I-655)+(2.052)+(15.012), (I-655)+(2.052)+(15.016), (I-655)+(2.052)+(15.025), (I-655)+(2.052)+(15.027), (I-655)+(2.052)+(15.047), (I-655)+(2.052)+(15.063), (I-655)+(2.052)+(15.064), (I-655)+(2.052)+(16.001), (I-655)+(2.052)+(16.002), (I-655)+(2.052)+(16.003), (I-655)+(2.052)+(16.004), (I-655)+(2.052)+(16.005), (I-655)+(2.052)+(16.006), (I-655)+(2.052)+(16.007), (I-655)+(2.052)+(16.008), (I-655)+(2.052)+(17.001), (I-655)+(2.052)+(17.002), (I-655)+(2.052)+(17.003), (I-655)+(2.052)+(17.004), (I-655)+(2.052)+(17.005), (I-655)+(2.052)+(17.006), (I-655)+(2.052)+(17.007), (I-655)+(2.052)+(17.008), (I-655)+(2.052)+(17.009), (I-655)+(2.052)+(17.010), (I-655)+(2.052)+(17.011), (I-655)+(2.052)+(17.012), (I-655)+(2.052)+(18.001),

(I-655)+(2.053)+(3.001), (I-655)+(2.053)+(3.002), (I-655)+(2.053)+(3.003), (I-655)+(2.053)+(3.004), (I-655)+(2.053)+(3.005), (I-655)+(2.053)+(3.006), (I-655)+(2.053)+(3.007), (I-655)+(2.053)+(3.008), (I-655)+(2.053)+(3.009), (I-655)+(2.053)+(3.010), (I-655)+(2.053)+(3.011), (I-655)+(2.053)+(3.012), (I-655)+(2.053)+(3.013), (I-655)+(2.053)+(3.014), (I-655)+(2.053)+(3.015), (I-655)+(2.053)+(3.016), (I-655)+(2.053)+(3.017), (I-655)+(2.053)+(3.018), (I-655)+(2.053)+(3.019), (I-655)+(2.053)+(3.020), (I-655)+(2.053)+(3.021), (I-655)+(2.053)+(3.022), (I-655)+(2.053)+(3.023), (I-655)+(2.053)+(3.024), (I-655)+(2.053)+(3.025), (I-655)+(2.053)+(3.026), (I-655)+(2.053)+(3.027), (I-655)+(2.053)+(3.028), (I-655)+(2.053)+(3.029), (I-655)+(2.053)+(3.030), (I-655)+(2.053)+(3.031), (I-655)+(2.053)+(5.001), (I-655)+(2.053)+(5.002), (I-655)+(2.053)+(5.003), (I-655)+(2.053)+(5.004), (I-655)+(2.053)+(5.005), (I-655)+(2.053)+(5.006), (I-655)+(2.053)+(5.007), (I-655)+(2.053)+(5.008), (I-655)+(2.053)+(5.009), (I-655)+(2.053)+(5.010), (I-655)+(2.053)+(5.011), (I-655)+(2.053)+(5.012), (I-655)+(2.053)+(5.013), (I-655)+(2.053)+(5.014), (I-655)+(2.053)+(5.015), (I-655)+(2.053)+(5.016), (I-655)+(2.053)+(5.017), (I-655)+(2.053)+(5.018), (I-655)+(2.053)+(5.019), (I-655)+(2.053)+(5.020), (I-655)+(2.053)+(5.021), (I-655)+(2.053)+(5.022), (I-655)+(2.053)+(5.023), (I-655)+(2.053)+(6.001), (I-655)+(2.053)+(6.002), (I-655)+(2.053)+(6.003), (I-655)+(2.053)+(6.004), (I-655)+(2.053)+(7.001), (I-655)+(2.053)+(7.002), (I-655)+(2.053)+(7.003), (I-655)+(2.053)+(7.004), (I-655)+(2.053)+(7.005), (I-655)+(2.053)+(7.006), (I-655)+(2.053)+(9.001), (I-655)+(2.053)+(9.002), (I-655)+(2.053)+(9.003), (I-655)+(2.053)+(9.004), (I-655)+(2.053)+(9.005), (I-655)+(2.053)+(9.006), (I-655)+(2.053)+(9.007), (I-655)+(2.053)+(9.008), (I-655)+(2.053)+(9.009), (I-655)+(2.053)+(14.001), (I-655)+(2.053)+(14.002), (I-655)+(2.053)+(15.008), (I-655)+(2.053)+(15.011), (I-655)+(2.053)+(15.012), (I-655)+(2.053)+(15.016), (I-655)+(2.053)+(15.025), (I-655)+(2.053)+(15.027), (I-655)+(2.053)+(15.047), (I-655)+(2.053)+(15.063), (I-655)+(2.053)+(15.064), (I-655)+(2.053)+(16.001), (I-655)+(2.053)+(16.002), (I-655)+(2.053)+(16.003), (I-655)+(2.053)+(16.004), (I-655)+(2.053)+(16.005), (I-655)+(2.053)+(16.006), (I-655)+(2.053)+(16.007), (I-655)+(2.053)+(16.008), (I-655)+(2.053)+(17.001), (I-655)+(2.053)+(17.002), (I-655)+(2.053)+(17.003), (I-655)+(2.053)+(17.004), (I-655)+(2.053)+(17.005), (I-655)+(2.053)+(17.006), (I-655)+(2.053)+(17.007), (I-655)+(2.053)+(17.008), (I-655)+(2.053)+(17.009), (I-655)+(2.053)+(17.010), (I-655)+(2.053)+(17.011), (I-655)+(2.053)+(17.012), (I-655)+(2.053)+(18.001),

(I-655)+(2.054)+(3.001), (I-655)+(2.054)+(3.002), (I-655)+(2.054)+(3.003), (I-655)+(2.054)+(3.004), (I-655)+(2.054)+(3.005), (I-655)+(2.054)+(3.006), (I-655)+(2.054)+(3.007), (I-655)+(2.054)+(3.008), (I-655)+(2.054)+(3.009), (I-655)+(2.054)+(3.010), (I-655)+(2.054)+(3.011), (I-655)+(2.054)+(3.012), (I-655)+(2.054)+(3.013), (I-655)+(2.054)+(3.014), (I-655)+(2.054)+(3.015), (I-655)+(2.054)+(3.016), (I-655)+(2.054)+(3.017), (I-655)+(2.054)+(3.018), (I-655)+(2.054)+(3.019), (I-655)+(2.054)+(3.020), (I-655)+(2.054)+(3.021), (I-655)+(2.054)+(3.022), (I-655)+(2.054)+(3.023), (I-655)+(2.054)+(3.024), (I-655)+(2.054)+(3.025), (I-655)+(2.054)+(3.026), (I-655)+(2.054)+(3.027), (I-655)+(2.054)+(3.028), (I-655)+(2.054)+(3.029), (I-655)+(2.054)+(3.030), (I-655)+(2.054)+(3.031), (I-655)+(2.054)+(5.001), (I-655)+(2.054)+(5.002), (I-655)+(2.054)+(5.003), (I-655)+(2.054)+(5.004), (I-655)+(2.054)+(5.005), (I-655)+(2.054)+(5.006), (I-655)+(2.054)+(5.007), (I-655)+(2.054)+(5.008), (I-655)+(2.054)+(5.009), (I-655)+(2.054)+(5.010), (I-655)+(2.054)+(5.011), (I-655)+(2.054)+(5.012), (I-655)+(2.054)+(5.013), (I-655)+(2.054)+(5.014), (I-655)+(2.054)+(5.015), (I-655)+(2.054)+(5.016), (I-655)+(2.054)+(5.017), (I-655)+(2.054)+(5.018), (I-655)+(2.054)+(5.019), (I-655)+(2.054)+(5.020), (I-655)+(2.054)+(5.021), (I-655)+(2.054)+(5.022), (I-655)+(2.054)+(5.023), (I-655)+(2.054)+(6.001), (I-655)+(2.054)+(6.002), (I-655)+(2.054)+(6.003), (I-655)+(2.054)+(6.004), (I-655)+(2.054)+(7.001), (I-655)+(2.054)+(7.002), (I-655)+(2.054)+(7.003), (I-655)+(2.054)+(7.004), (I-655)+(2.054)+(7.005), (I-655)+(2.054)+(7.006), (I-655)+(2.054)+(9.001), (I-655)+(2.054)+(9.002), (I-655)+(2.054)+(9.003), (I-655)+(2.054)+(9.004), (I-655)+(2.054)+(9.005), (I-655)+(2.054)+(9.006), (I-655)+(2.054)+(9.007), (I-655)+(2.054)+(9.008), (I-655)+(2.054)+(9.009), (I-655)+(2.054)+(14.001), (I-655)+(2.054)+(14.002), (I-655)+(2.054)+(15.008), (I-655)+(2.054)+(15.011), (I-655)+(2.054)+(15.012), (I-655)+(2.054)+(15.016), (I-655)+(2.054)+(15.025), (I-655)+(2.054)+(15.027), (I-655)+(2.054)+(15.047), (I-655)+(2.054)+(15.063), (I-655)+(2.054)+(15.064), (I-655)+(2.054)+(16.001), (I-655)+(2.054)+(16.002), (I-655)+(2.054)+(16.003), (I-655)+(2.054)+(16.004), (I-655)+(2.054)+(16.005), (I-655)+(2.054)+(16.006), (I-655)+(2.054)+(16.007), (I-655)+(2.054)+(16.008), (I-655)+(2.054)+(17.001), (I-655)+(2.054)+(17.002), (I-655)+(2.054)+(17.003), (I-655)+(2.054)+(17.004), (I-655)+(2.054)+(17.005), (I-655)+(2.054)+(17.006), (I-655)+(2.054)+(17.007), (I-655)+(2.054)+(17.008), (I-655)+(2.054)+(17.009), (I-655)+(2.054)+(17.010), (I-655)+(2.054)+(17.011), (I-655)+(2.054)+(17.012), (I-655)+(2.054)+(18.001),

(I-655)+(2.055)+(3.001), (I-655)+(2.055)+(3.002), (I-655)+(2.055)+(3.003), (I-655)+(2.055)+(3.004), (I-655)+(2.055)+(3.005), (I-655)+(2.055)+(3.006), (I-655)+(2.055)+(3.007), (I-655)+(2.055)+(3.008), (I-655)+(2.055)+(3.009), (I-655)+(2.055)+(3.010), (I-655)+(2.055)+(3.011), (I-655)+(2.055)+(3.012), (I-655)+(2.055)+(3.013), (I-655)+(2.055)+(3.014), (I-655)+(2.055)+(3.015), (I-655)+(2.055)+(3.016), (I-655)+(2.055)+(3.017), (I-655)+(2.055)+(3.018), (I-655)+(2.055)+(3.019), (I-655)+(2.055)+(3.020), (I-655)+(2.055)+(3.021), (I-655)+(2.055)+(3.022), (I-655)+(2.055)+(3.023), (I-655)+(2.055)+(3.024), (I-655)+(2.055)+(3.025), (I-655)+(2.055)+(3.026), (I-655)+(2.055)+(3.027), (I-655)+(2.055)+(3.028), (I-655)+(2.055)+(3.029), (I-655)+(2.055)+(3.030), (I-655)+(2.055)+(3.031), (I-655)+(2.055)+(5.001), (I-655)+(2.055)+(5.002), (I-655)+(2.055)+(5.003), (I-655)+(2.055)+(5.004), (I-655)+(2.055)+(5.005), (I-655)+(2.055)+(5.006), (I-655)+(2.055)+(5.007), (I-655)+(2.055)+(5.008), (I-655)+(2.055)+(5.009), (I-655)+(2.055)+(5.010), (I-655)+(2.055)+(5.011), (I-655)+(2.055)+(5.012), (I-655)+(2.055)+(5.013), (I-655)+(2.055)+(5.014), (I-655)+(2.055)+(5.015), (I-655)+(2.055)+(5.016), (I-655)+(2.055)+(5.017), (I-655)+(2.055)+(5.018), (I-655)+(2.055)+(5.019), (I-655)+(2.055)+(5.020), (I-655)+(2.055)+(5.021), (I-655)+(2.055)+(5.022), (I-655)+(2.055)+(5.023), (I-655)+(2.055)+(6.001), (I-655)+(2.055)+(6.002), (I-655)+(2.055)+(6.003), (I-655)+(2.055)+(6.004), (I-655)+(2.055)+(7.001), (I-655)+(2.055)+(7.002), (I-655)+(2.055)+(7.003), (I-655)+(2.055)+(7.004), (I-655)+(2.055)+(7.005), (I-655)+(2.055)+(7.006), (I-655)+(2.055)+(9.001), (I-655)+(2.055)+(9.002), (I-655)+(2.055)+(9.003), (I-655)+(2.055)+(9.004), (I-655)+(2.055)+(9.005), (I-655)+(2.055)+(9.006), (I-655)+(2.055)+(9.007), (I-655)+(2.055)+(9.008), (I-655)+(2.055)+(9.009), (I-655)+(2.055)+(14.001), (I-655)+(2.055)+(14.002), (I-655)+(2.055)+(15.008), (I-655)+(2.055)+(15.011), (I-655)+(2.055)+(15.012), (I-655)+(2.055)+(15.016), (I-655)+(2.055)+(15.025), (I-655)+(2.055)+(15.027), (I-655)+(2.055)+(15.047), (I-655)+(2.055)+(15.063), (I-655)+(2.055)+(15.064), (I-655)+(2.055)+(16.001), (I-655)+(2.055)+(16.002), (I-655)+(2.055)+(16.003), (I-655)+(2.055)+(16.004), (I-655)+(2.055)+(16.005), (I-655)+(2.055)+(16.006), (I-655)+(2.055)+(16.007), (I-655)+(2.055)+(16.008), (I-655)+(2.055)+(17.001), (I-655)+(2.055)+(17.002), (I-655)+(2.055)+(17.003), (I-655)+(2.055)+(17.004), (I-655)+(2.055)+(17.005), (I-655)+(2.055)+(17.006), (I-655)+(2.055)+(17.007), (I-655)+(2.055)+(17.008), (I-655)+(2.055)+(17.009), (I-655)+(2.055)+(17.010), (I-655)+(2.055)+(17.011), (I-655)+(2.055)+(17.012), (I-655)+(2.055)+(18.001),

(I-655)+(2.056)+(3.001), (I-655)+(2.056)+(3.002), (I-655)+(2.056)+(3.003), (I-655)+(2.056)+(3.004), (I-655)+(2.056)+(3.005), (I-655)+(2.056)+(3.006), (I-655)+(2.056)+(3.007), (I-655)+(2.056)+(3.008), (I-655)+(2.056)+(3.009), (I-655)+(2.056)+(3.010), (I-655)+(2.056)+(3.011), (I-655)+(2.056)+(3.012), (I-655)+(2.056)+(3.013), (I-655)+(2.056)+(3.014), (I-655)+(2.056)+(3.015), (I-655)+(2.056)+(3.016), (I-655)+(2.056)+(3.017), (I-655)+(2.056)+(3.018), (I-655)+(2.056)+(3.019), (I-655)+(2.056)+(3.020), (I-655)+(2.056)+(3.021), (I-655)+(2.056)+(3.022), (I-655)+(2.056)+(3.023), (I-655)+(2.056)+(3.024), (I-655)+(2.056)+(3.025), (I-655)+(2.056)+(3.026), (I-655)+(2.056)+(3.027), (I-655)+(2.056)+(3.028), (I-655)+(2.056)+(3.029), (I-655)+(2.056)+(3.030), (I-655)+(2.056)+(3.031), (I-655)+(2.056)+(5.001), (I-655)+(2.056)+(5.002), (I-655)+(2.056)+(5.003), (I-655)+(2.056)+(5.004), (I-655)+(2.056)+(5.005), (I-655)+(2.056)+(5.006), (I-655)+(2.056)+(5.007), (I-655)+(2.056)+(5.008), (I-655)+(2.056)+(5.009), (I-655)+(2.056)+(5.010), (I-655)+(2.056)+(5.011), (I-655)+(2.056)+(5.012), (I-655)+(2.056)+(5.013), (I-655)+(2.056)+(5.014), (I-655)+(2.056)+(5.015), (I-655)+(2.056)+(5.016), (I-655)+(2.056)+(5.017), (I-655)+(2.056)+(5.018), (I-655)+(2.056)+(5.019), (I-655)+(2.056)+(5.020), (I-655)+(2.056)+(5.021), (I-655)+(2.056)+(5.022), (I-655)+(2.056)+(5.023), (I-655)+(2.056)+(6.001), (I-655)+(2.056)+(6.002), (I-655)+(2.056)+(6.003), (I-655)+(2.056)+(6.004), (I-655)+(2.056)+(7.001), (I-655)+(2.056)+(7.002), (I-655)+(2.056)+(7.003), (I-655)+(2.056)+(7.004), (I-655)+(2.056)+(7.005), (I-655)+(2.056)+(7.006), (I-655)+(2.056)+(9.001), (I-655)+(2.056)+(9.002), (I-655)+(2.056)+(9.003), (I-655)+(2.056)+(9.004), (I-655)+(2.056)+(9.005), (I-655)+(2.056)+(9.006), (I-655)+(2.056)+(9.007), (I-655)+(2.056)+(9.008), (I-655)+(2.056)+(9.009), (I-655)+(2.056)+(14.001), (I-655)+(2.056)+(14.002), (I-655)+(2.056)+(15.008), (I-655)+(2.056)+(15.011), (I-655)+(2.056)+(15.012), (I-655)+(2.056)+(15.016), (I-655)+(2.056)+(15.025), (I-655)+(2.056)+(15.027), (I-655)+(2.056)+(15.047), (I-655)+(2.056)+(15.063), (I-655)+(2.056)+(15.064), (I-655)+(2.056)+(16.001), (I-655)+(2.056)+(16.002), (I-655)+(2.056)+(16.003), (I-655)+(2.056)+(16.004), (I-655)+(2.056)+(16.005), (I-655)+(2.056)+(16.006), (I-655)+(2.056)+(16.007), (I-655)+(2.056)+(16.008), (I-655)+(2.056)+(17.001), (I-655)+(2.056)+(17.002), (I-655)+(2.056)+(17.003), (I-655)+(2.056)+(17.004), (I-655)+(2.056)+(17.005), (I-655)+(2.056)+(17.006), (I-655)+(2.056)+(17.007), (I-655)+(2.056)+(17.008), (I-655)+(2.056)+(17.009), (I-655)+(2.056)+(17.010), (I-655)+(2.056)+(17.011), (I-655)+(2.056)+(17.012), (I-655)+(2.056)+(18.001),

(I-655)+(2.057)+(3.001), (I-655)+(2.057)+(3.002), (I-655)+(2.057)+(3.003), (I-655)+(2.057)+(3.004), (I-655)+(2.057)+(3.005), (I-655)+(2.057)+(3.006), (I-655)+(2.057)+(3.007), (I-655)+(2.057)+(3.008), (I-655)+(2.057)+(3.009), (I-655)+(2.057)+(3.010), (I-655)+(2.057)+(3.011), (I-655)+(2.057)+(3.012), (I-655)+(2.057)+(3.013), (I-655)+(2.057)+(3.014), (I-655)+(2.057)+(3.015), (I-655)+(2.057)+(3.016), (I-655)+(2.057)+(3.017), (I-655)+(2.057)+(3.018), (I-655)+(2.057)+(3.019), (I-655)+(2.057)+(3.020), (I-655)+(2.057)+(3.021), (I-655)+(2.057)+(3.022), (I-655)+(2.057)+(3.023), (I-655)+(2.057)+(3.024), (I-655)+(2.057)+(3.025), (I-655)+(2.057)+(3.026), (I-655)+(2.057)+(3.027), (I-655)+(2.057)+(3.028), (I-655)+(2.057)+(3.029), (I-655)+(2.057)+(3.030), (I-655)+(2.057)+(3.031), (I-655)+(2.057)+(5.001), (I-655)+(2.057)+(5.002), (I-655)+(2.057)+(5.003), (I-655)+(2.057)+(5.004), (I-655)+(2.057)+(5.005), (I-655)+(2.057)+(5.006), (I-655)+(2.057)+(5.007), (I-655)+(2.057)+(5.008), (I-655)+(2.057)+(5.009), (I-655)+(2.057)+(5.010), (I-655)+(2.057)+(5.011), (I-655)+(2.057)+(5.012), (I-655)+(2.057)+(5.013), (I-655)+(2.057)+(5.014), (I-655)+(2.057)+(5.015), (I-655)+(2.057)+(5.016), (I-655)+(2.057)+(5.017), (I-655)+(2.057)+(5.018), (I-655)+(2.057)+(5.019), (I-655)+(2.057)+(5.020), (I-655)+(2.057)+(5.021), (I-655)+(2.057)+(5.022), (I-655)+(2.057)+(5.023), (I-655)+(2.057)+(6.001), (I-655)+(2.057)+(6.002), (I-655)+(2.057)+(6.003), (I-655)+(2.057)+(6.004), (I-655)+(2.057)+(7.001), (I-655)+(2.057)+(7.002), (I-655)+(2.057)+(7.003), (I-655)+(2.057)+(7.004), (I-655)+(2.057)+(7.005), (I-655)+(2.057)+(7.006), (I-655)+(2.057)+(9.001), (I-655)+(2.057)+(9.002), (I-655)+(2.057)+(9.003), (I-655)+(2.057)+(9.004), (I-655)+(2.057)+(9.005), (I-655)+(2.057)+(9.006), (I-655)+(2.057)+(9.007), (I-655)+(2.057)+(9.008), (I-655)+(2.057)+(9.009), (I-655)+(2.057)+(14.001), (I-655)+(2.057)+(14.002), (I-655)+(2.057)+(15.008), (I-655)+(2.057)+(15.011), (I-655)+(2.057)+(15.012), (I-655)+(2.057)+(15.016), (I-655)+(2.057)+(15.025), (I-655)+(2.057)+(15.027), (I-655)+(2.057)+(15.047), (I-655)+(2.057)+(15.063), (I-655)+(2.057)+(15.064), (I-655)+(2.057)+(16.001), (I-655)+(2.057)+(16.002), (I-655)+(2.057)+(16.003), (I-655)+(2.057)+(16.004), (I-655)+(2.057)+(16.005), (I-655)+(2.057)+(16.006), (I-655)+(2.057)+(16.007), (I-655)+(2.057)+(16.008), (I-655)+(2.057)+(17.001), (I-655)+(2.057)+(17.002), (I-655)+(2.057)+(17.003), (I-655)+(2.057)+(17.004), (I-655)+(2.057)+(17.005), (I-655)+(2.057)+(17.006), (I-655)+(2.057)+(17.007), (I-655)+(2.057)+(17.008), (I-655)+(2.057)+(17.009), (I-655)+(2.057)+(17.010), (I-655)+(2.057)+(17.011), (I-655)+(2.057)+(17.012), (I-655)+(2.057)+(18.001),

(I-655)+(2.058)+(3.001), (I-655)+(2.058)+(3.002), (I-655)+(2.058)+(3.003), (I-655)+(2.058)+(3.004), (I-655)+(2.058)+(3.005), (I-655)+(2.058)+(3.006), (I-655)+(2.058)+(3.007), (I-655)+(2.058)+(3.008), (I-655)+(2.058)+(3.009), (I-655)+(2.058)+(3.010), (I-655)+(2.058)+(3.011), (I-655)+(2.058)+(3.012), (I-655)+(2.058)+(3.013), (I-655)+(2.058)+(3.014), (I-655)+(2.058)+(3.015), (I-655)+(2.058)+(3.016), (I-655)+(2.058)+(3.017), (I-655)+(2.058)+(3.018), (I-655)+(2.058)+(3.019), (I-655)+(2.058)+(3.020), (I-655)+(2.058)+(3.021), (I-655)+(2.058)+(3.022), (I-655)+(2.058)+(3.023), (I-655)+(2.058)+(3.024), (I-655)+(2.058)+(3.025), (I-655)+(2.058)+(3.026), (I-655)+(2.058)+(3.027), (I-655)+(2.058)+(3.028), (I-655)+(2.058)+(3.029), (I-655)+(2.058)+(3.030), (I-655)+(2.058)+(3.031), (I-655)+(2.058)+(5.001), (I-655)+(2.058)+(5.002), (I-655)+(2.058)+(5.003), (I-655)+(2.058)+(5.004), (I-655)+(2.058)+(5.005), (I-655)+(2.058)+(5.006), (I-655)+(2.058)+(5.007), (I-655)+(2.058)+(5.008), (I-655)+(2.058)+(5.009), (I-655)+(2.058)+(5.010), (I-655)+(2.058)+(5.011), (I-655)+(2.058)+(5.012), (I-655)+(2.058)+(5.013), (I-655)+(2.058)+(5.014), (I-655)+(2.058)+(5.015), (I-655)+(2.058)+(5.016), (I-655)+(2.058)+(5.017), (I-655)+(2.058)+(5.018), (I-655)+(2.058)+(5.019), (I-655)+(2.058)+(5.020), (I-655)+(2.058)+(5.021), (I-655)+(2.058)+(5.022), (I-655)+(2.058)+(5.023), (I-655)+(2.058)+(6.001), (I-655)+(2.058)+(6.002), (I-655)+(2.058)+(6.003), (I-655)+(2.058)+(6.004), (I-655)+(2.058)+(7.001), (I-655)+(2.058)+(7.002), (I-655)+(2.058)+(7.003), (I-655)+(2.058)+(7.004), (I-655)+(2.058)+(7.005), (I-655)+(2.058)+(7.006), (I-655)+(2.058)+(9.001), (I-655)+(2.058)+(9.002), (I-655)+(2.058)+(9.003), (I-655)+(2.058)+(9.004), (I-655)+(2.058)+(9.005), (I-655)+(2.058)+(9.006), (I-655)+(2.058)+(9.007), (I-655)+(2.058)+(9.008), (I-655)+(2.058)+(9.009), (I-655)+(2.058)+(14.001), (I-655)+(2.058)+(14.002), (I-655)+(2.058)+(15.008), (I-655)+(2.058)+(15.011), (I-655)+(2.058)+(15.012), (I-655)+(2.058)+(15.016), (I-655)+(2.058)+(15.025), (I-655)+(2.058)+(15.027), (I-655)+(2.058)+(15.047), (I-655)+(2.058)+(15.063), (I-655)+(2.058)+(15.064), (I-655)+(2.058)+(16.001), (I-655)+(2.058)+(16.002), (I-655)+(2.058)+(16.003), (I-655)+(2.058)+(16.004), (I-655)+(2.058)+(16.005), (I-655)+(2.058)+(16.006), (I-655)+(2.058)+(16.007), (I-655)+(2.058)+(16.008), (I-655)+(2.058)+(17.001), (I-655)+(2.058)+(17.002), (I-655)+(2.058)+(17.003), (I-655)+(2.058)+(17.004), (I-655)+(2.058)+(17.005), (I-655)+(2.058)+(17.006), (I-655)+(2.058)+(17.007), (I-655)+(2.058)+(17.008), (I-655)+(2.058)+(17.009), (I-655)+(2.058)+(17.010), (I-655)+(2.058)+(17.011), (I-655)+(2.058)+(17.012), (I-655)+(2.058)+(18.001),

(I-655)+(2.059)+(3.001), (I-655)+(2.059)+(3.002), (I-655)+(2.059)+(3.003), (I-655)+(2.059)+(3.004), (I-655)+(2.059)+(3.005), (I-655)+(2.059)+(3.006), (I-655)+(2.059)+(3.007), (I-655)+(2.059)+(3.008), (I-655)+(2.059)+(3.009), (I-655)+(2.059)+(3.010), (I-655)+(2.059)+(3.011), (I-655)+(2.059)+(3.012), (I-655)+(2.059)+(3.013), (I-655)+(2.059)+(3.014), (I-655)+(2.059)+(3.015), (I-655)+(2.059)+(3.016), (I-655)+(2.059)+(3.017), (I-655)+(2.059)+(3.018), (I-655)+(2.059)+(3.019), (I-655)+(2.059)+(3.020), (I-655)+(2.059)+(3.021), (I-655)+(2.059)+(3.022), (I-655)+(2.059)+(3.023), (I-655)+(2.059)+(3.024), (I-655)+(2.059)+(3.025), (I-655)+(2.059)+(3.026), (I-655)+(2.059)+(3.027), (I-655)+(2.059)+(3.028), (I-655)+(2.059)+(3.029), (I-655)+(2.059)+(3.030), (I-655)+(2.059)+(3.031), (I-655)+(2.059)+(5.001), (I-655)+(2.059)+(5.002), (I-655)+(2.059)+(5.003), (I-655)+(2.059)+(5.004), (I-655)+(2.059)+(5.005), (I-655)+(2.059)+(5.006), (I-655)+(2.059)+(5.007), (I-655)+(2.059)+(5.008), (I-655)+(2.059)+(5.009), (I-655)+(2.059)+(5.010), (I-655)+(2.059)+(5.011), (I-655)+(2.059)+(5.012), (I-655)+(2.059)+(5.013), (I-655)+(2.059)+(5.014), (I-655)+(2.059)+(5.015), (I-655)+(2.059)+(5.016), (I-655)+(2.059)+(5.017), (I-655)+(2.059)+(5.018), (I-655)+(2.059)+(5.019), (I-655)+(2.059)+(5.020), (I-655)+(2.059)+(5.021), (I-655)+(2.059)+(5.022), (I-655)+(2.059)+(5.023), (I-655)+(2.059)+(6.001), (I-655)+(2.059)+(6.002), (I-655)+(2.059)+(6.003), (I-655)+(2.059)+(6.004), (I-655)+(2.059)+(7.001), (I-655)+(2.059)+(7.002), (I-655)+(2.059)+(7.003), (I-655)+(2.059)+(7.004), (I-655)+(2.059)+(7.005), (I-655)+(2.059)+(7.006), (I-655)+(2.059)+(9.001), (I-655)+(2.059)+(9.002), (I-655)+(2.059)+(9.003), (I-655)+(2.059)+(9.004), (I-655)+(2.059)+(9.005), (I-655)+(2.059)+(9.006), (I-655)+(2.059)+(9.007), (I-655)+(2.059)+(9.008), (I-655)+(2.059)+(9.009), (I-655)+(2.059)+(14.001), (I-655)+(2.059)+(14.002), (I-655)+(2.059)+(15.008), (I-655)+(2.059)+(15.011), (I-655)+(2.059)+(15.012), (I-655)+(2.059)+(15.016), (I-655)+(2.059)+(15.025), (I-655)+(2.059)+(15.027), (I-655)+(2.059)+(15.047), (I-655)+(2.059)+(15.063), (I-655)+(2.059)+(15.064), (I-655)+(2.059)+(16.001), (I-655)+(2.059)+(16.002), (I-655)+(2.059)+(16.003), (I-655)+(2.059)+(16.004), (I-655)+(2.059)+(16.005), (I-655)+(2.059)+(16.006), (I-655)+(2.059)+(16.007), (I-655)+(2.059)+(16.008), (I-655)+(2.059)+(17.001), (I-655)+(2.059)+(17.002), (I-655)+(2.059)+(17.003), (I-655)+(2.059)+(17.004), (I-655)+(2.059)+(17.005), (I-655)+(2.059)+(17.006), (I-655)+(2.059)+(17.007), (I-655)+(2.059)+(17.008), (I-655)+(2.059)+(17.009), (I-655)+(2.059)+(17.010), (I-655)+(2.059)+(17.011), (I-655)+(2.059)+(17.012), (I-655)+(2.059)+(18.001),

(I-655)+(3.001)+(3.025), (I-655)+(3.001)+(3.030), (I-655)+(3.001)+(3.031), (I-655)+(3.001)+(5.001), (I-655)+(3.001)+(5.002), (I-655)+(3.001)+(5.003), (I-655)+(3.001)+(5.004), (I-655)+(3.001)+(5.005), (I-655)+(3.001)+(5.006), (I-655)+(3.001)+(5.007), (I-655)+(3.001)+(5.008), (I-655)+(3.001)+(5.009), (I-655)+(3.001)+(5.010), (I-655)+(3.001)+(5.011), (I-655)+(3.001)+(5.012), (I-655)+(3.001)+(5.013), (I-655)+(3.001)+(5.014), (I-655)+(3.001)+(5.015), (I-655)+(3.001)+(5.016), (I-655)+(3.001)+(5.017), (I-655)+(3.001)+(5.018), (I-655)+(3.001)+(5.019), (I-655)+(3.001)+(5.020), (I-655)+(3.001)+(5.021), (I-655)+(3.001)+(5.022), (I-655)+(3.001)+(5.023), (I-655)+(3.001)+(6.001), (I-655)+(3.001)+(6.002), (I-655)+(3.001)+(6.003), (I-655)+(3.001)+(6.004), (I-655)+(3.001)+(7.001), (I-655)+(3.001)+(7.002), (I-655)+(3.001)+(7.003), (I-655)+(3.001)+(7.004), (I-655)+(3.001)+(7.005), (I-655)+(3.001)+(7.006), (I-655)+(3.001)+(9.001), (I-655)+(3.001)+(9.002), (I-655)+(3.001)+(9.003), (I-655)+(3.001)+(9.004), (I-655)+(3.001)+(9.005), (I-655)+(3.001)+(9.006), (I-655)+(3.001)+(9.007), (I-655)+(3.001)+(9.008), (I-655)+(3.001)+(9.009), (I-655)+(3.001)+(14.001), (I-655)+(3.001)+(14.002), (I-655)+(3.001)+(15.008), (I-655)+(3.001)+(15.011), (I-655)+(3.001)+(15.012), (I-655)+(3.001)+(15.016), (I-655)+(3.001)+(15.025), (I-655)+(3.001)+(15.027), (I-655)+(3.001)+(15.047), (I-655)+(3.001)+(15.063), (I-655)+(3.001)+(15.064), (I-655)+(3.001)+(16.001), (I-655)+(3.001)+(16.002), (I-655)+(3.001)+(16.003), (I-655)+(3.001)+(16.004), (I-655)+(3.001)+(16.005), (I-655)+(3.001)+(16.006), (I-655)+(3.001)+(16.007), (I-655)+(3.001)+(16.008), (I-655)+(3.001)+(17.001), (I-655)+(3.001)+(17.002), (I-655)+(3.001)+(17.003), (I-655)+(3.001)+(17.004), (I-655)+(3.001)+(17.005), (I-655)+(3.001)+(17.006), (I-655)+(3.001)+(17.007), (I-655)+(3.001)+(17.008), (I-655)+(3.001)+(17.009), (I-655)+(3.001)+(17.010), (I-655)+(3.001)+(17.011), (I-655)+(3.001)+(17.012), (I-655)+(3.001)+(18.001),

(I-655)+(3.002)+(3.025), (I-655)+(3.002)+(3.030), (I-655)+(3.002)+(3.031), (I-655)+(3.002)+(5.001), (I-655)+(3.002)+(5.002), (I-655)+(3.002)+(5.003), (I-655)+(3.002)+(5.004), (I-655)+(3.002)+(5.005), (I-655)+(3.002)+(5.006), (I-655)+(3.002)+(5.007), (I-655)+(3.002)+(5.008), (I-655)+(3.002)+(5.009), (I-655)+(3.002)+(5.010), (I-655)+(3.002)+(5.011), (I-655)+(3.002)+(5.012), (I-655)+(3.002)+(5.013), (I-655)+(3.002)+(5.014), (I-655)+(3.002)+(5.015), (I-655)+(3.002)+(5.016), (I-655)+(3.002)+(5.017), (I-655)+(3.002)+(5.018), (I-655)+(3.002)+(5.019), (I-655)+(3.002)+(5.020), (I-655)+(3.002)+(5.021), (I-655)+(3.002)+(5.022), (I-655)+(3.002)+(5.023), (I-655)+(3.002)+(6.001), (I-655)+(3.002)+(6.002), (I-655)+(3.002)+(6.003), (I-655)+(3.002)+(6.004), (I-655)+(3.002)+(7.001), (I-655)+(3.002)+(7.002), (I-655)+(3.002)+(7.003), (I-655)+(3.002)+(7.004), (I-655)+(3.002)+(7.005), (I-655)+(3.002)+(7.006), (I-655)+(3.002)+(9.001), (I-655)+(3.002)+(9.002), (I-655)+(3.002)+(9.003), (I-655)+(3.002)+(9.004), (I-655)+(3.002)+(9.005), (I-655)+(3.002)+(9.006), (I-655)+(3.002)+(9.007), (I-655)+(3.002)+(9.008), (I-655)+(3.002)+(9.009), (I-655)+(3.002)+(14.001), (I-655)+(3.002)+(14.002), (I-655)+(3.002)+(15.008), (I-655)+(3.002)+(15.011), (I-655)+(3.002)+(15.012), (I-655)+(3.002)+(15.016), (I-655)+(3.002)+(15.025), (I-655)+(3.002)+(15.027), (I-655)+(3.002)+(15.047), (I-655)+(3.002)+(15.063), (I-655)+(3.002)+(15.064), (I-655)+(3.002)+(16.001), (I-655)+(3.002)+(16.002), (I-655)+(3.002)+(16.003), (I-655)+(3.002)+(16.004), (I-655)+(3.002)+(16.005), (I-655)+(3.002)+(16.006), (I-655)+(3.002)+(16.007), (I-655)+(3.002)+(16.008), (I-655)+(3.002)+(17.001), (I-655)+(3.002)+(17.002), (I-655)+(3.002)+(17.003), (I-655)+(3.002)+(17.004), (I-655)+(3.002)+(17.005), (I-655)+(3.002)+(17.006), (I-655)+(3.002)+(17.007), (I-655)+(3.002)+(17.008), (I-655)+(3.002)+(17.009), (I-655)+(3.002)+(17.010), (I-655)+(3.002)+(17.011), (I-655)+(3.002)+(17.012), (I-655)+(3.002)+(18.001),

(I-655)+(3.003)+(3.025), (I-655)+(3.003)+(3.030), (I-655)+(3.003)+(3.031), (I-655)+(3.003)+(5.001), (I-655)+(3.003)+(5.002), (I-655)+(3.003)+(5.003), (I-655)+(3.003)+(5.004), (I-655)+(3.003)+(5.005), (I-655)+(3.003)+(5.006), (I-655)+(3.003)+(5.007), (I-655)+(3.003)+(5.008), (I-655)+(3.003)+(5.009), (I-655)+(3.003)+(5.010), (I-655)+(3.003)+(5.011), (I-655)+(3.003)+(5.012), (I-655)+(3.003)+(5.013), (I-655)+(3.003)+(5.014), (I-655)+(3.003)+(5.015), (I-655)+(3.003)+(5.016), (I-655)+(3.003)+(5.017), (I-655)+(3.003)+(5.018), (I-655)+(3.003)+(5.019), (I-655)+(3.003)+(5.020), (I-655)+(3.003)+(5.021), (I-655)+(3.003)+(5.022), (I-655)+(3.003)+(5.023), (I-655)+(3.003)+(6.001), (I-655)+(3.003)+(6.002), (I-655)+(3.003)+(6.003), (I-655)+(3.003)+(6.004), (I-655)+(3.003)+(7.001), (I-655)+(3.003)+(7.002), (I-655)+(3.003)+(7.003), (I-655)+(3.003)+(7.004), (I-655)+(3.003)+(7.005), (I-655)+(3.003)+(7.006), (I-655)+(3.003)+(9.001), (I-655)+(3.003)+(9.002), (I-655)+(3.003)+(9.003), (I-655)+(3.003)+(9.004), (I-655)+(3.003)+(9.005), (I-655)+(3.003)+(9.006), (I-655)+(3.003)+(9.007), (I-655)+(3.003)+(9.008), (I-655)+(3.003)+(9.009), (I-655)+(3.003)+(14.001), (I-655)+(3.003)+(14.002), (I-655)+(3.003)+(15.008), (I-655)+(3.003)+(15.011), (I-655)+(3.003)+(15.012), (I-655)+(3.003)+(15.016), (I-655)+(3.003)+(15.025), (I-655)+(3.003)+(15.027), (I-655)+(3.003)+(15.047), (I-655)+(3.003)+(15.063), (I-655)+(3.003)+(15.064), (I-655)+(3.003)+(16.001), (I-655)+(3.003)+(16.002), (I-655)+(3.003)+(16.003), (I-655)+(3.003)+(16.004), (I-655)+(3.003)+(16.005), (I-655)+(3.003)+(16.006), (I-655)+(3.003)+(16.007), (I-655)+(3.003)+(16.008), (I-655)+(3.003)+(17.001), (I-655)+(3.003)+(17.002), (I-655)+(3.003)+(17.003), (I-655)+(3.003)+(17.004), (I-655)+(3.003)+(17.005), (I-655)+(3.003)+(17.006), (I-655)+(3.003)+(17.007), (I-655)+(3.003)+(17.008), (I-655)+(3.003)+(17.009), (I-655)+(3.003)+(17.010), (I-655)+(3.003)+(17.011), (I-655)+(3.003)+(17.012), (I-655)+(3.003)+(18.001),

(I-655)+(3.004)+(3.025), (I-655)+(3.004)+(3.030), (I-655)+(3.004)+(3.031), (I-655)+(3.004)+(5.001), (I-655)+(3.004)+(5.002), (I-655)+(3.004)+(5.003), (I-655)+(3.004)+(5.004), (I-655)+(3.004)+(5.005), (I-655)+(3.004)+(5.006), (I-655)+(3.004)+(5.007), (I-655)+(3.004)+(5.008), (I-655)+(3.004)+(5.009), (I-655)+(3.004)+(5.010), (I-655)+(3.004)+(5.011), (I-655)+(3.004)+(5.012), (I-655)+(3.004)+(5.013), (I-655)+(3.004)+(5.014), (I-655)+(3.004)+(5.015), (I-655)+(3.004)+(5.016), (I-655)+(3.004)+(5.017), (I-655)+(3.004)+(5.018), (I-655)+(3.004)+(5.019), (I-655)+(3.004)+(5.020), (I-655)+(3.004)+(5.021), (I-655)+(3.004)+(5.022), (I-655)+(3.004)+(5.023), (I-655)+(3.004)+(6.001), (I-655)+(3.004)+(6.002), (I-655)+(3.004)+(6.003), (I-655)+(3.004)+(6.004), (I-655)+(3.004)+(7.001), (I-655)+(3.004)+(7.002), (I-655)+(3.004)+(7.003), (I-655)+(3.004)+(7.004), (I-655)+(3.004)+(7.005), (I-655)+(3.004)+(7.006), (I-655)+(3.004)+(9.001), (I-655)+(3.004)+(9.002), (I-655)+(3.004)+(9.003), (I-655)+(3.004)+(9.004), (I-655)+(3.004)+(9.005), (I-655)+(3.004)+(9.006), (I-655)+(3.004)+(9.007), (I-655)+(3.004)+(9.008), (I-655)+(3.004)+(9.009), (I-655)+(3.004)+(14.001), (I-655)+(3.004)+(14.002), (I-655)+(3.004)+(15.008), (I-655)+(3.004)+(15.011), (I-655)+(3.004)+(15.012), (I-655)+(3.004)+(15.016), (I-655)+(3.004)+(15.025), (I-655)+(3.004)+(15.027), (I-655)+(3.004)+(15.047), (I-655)+(3.004)+(15.063), (I-655)+(3.004)+(15.064), (I-655)+(3.004)+(16.001), (I-655)+(3.004)+(16.002), (I-655)+(3.004)+(16.003), (I-655)+(3.004)+(16.004), (I-655)+(3.004)+(16.005), (I-655)+(3.004)+(16.006), (I-655)+(3.004)+(16.007), (I-655)+(3.004)+(16.008), (I-655)+(3.004)+(17.001), (I-655)+(3.004)+(17.002), (I-655)+(3.004)+(17.003), (I-655)+(3.004)+(17.004), (I-655)+(3.004)+(17.005), (I-655)+(3.004)+(17.006), (I-655)+(3.004)+(17.007), (I-655)+(3.004)+(17.008), (I-655)+(3.004)+(17.009), (I-655)+(3.004)+(17.010), (I-655)+(3.004)+(17.011), (I-655)+(3.004)+(17.012), (I-655)+(3.004)+(18.001),

(I-655)+(3.005)+(3.025), (I-655)+(3.005)+(3.030), (I-655)+(3.005)+(3.031), (I-655)+(3.005)+(5.001), (I-655)+(3.005)+(5.002), (I-655)+(3.005)+(5.003), (I-655)+(3.005)+(5.004), (I-655)+(3.005)+(5.005), (I-655)+(3.005)+(5.006), (I-655)+(3.005)+(5.007), (I-655)+(3.005)+(5.008), (I-655)+(3.005)+(5.009), (I-655)+(3.005)+(5.010), (I-655)+(3.005)+(5.011), (I-655)+(3.005)+(5.012), (I-655)+(3.005)+(5.013), (I-655)+(3.005)+(5.014), (I-655)+(3.005)+(5.015), (I-655)+(3.005)+(5.016), (I-655)+(3.005)+(5.017), (I-655)+(3.005)+(5.018), (I-655)+(3.005)+(5.019), (I-655)+(3.005)+(5.020), (I-655)+(3.005)+(5.021), (I-655)+(3.005)+(5.022), (I-655)+(3.005)+(5.023), (I-655)+(3.005)+(6.001), (I-655)+(3.005)+(6.002), (I-655)+(3.005)+(6.003), (I-655)+(3.005)+(6.004), (I-655)+(3.005)+(7.001), (I-655)+(3.005)+(7.002), (I-655)+(3.005)+(7.003), (I-655)+(3.005)+(7.004), (I-655)+(3.005)+(7.005), (I-655)+(3.005)+(7.006), (I-655)+(3.005)+(9.001), (I-655)+(3.005)+(9.002), (I-655)+(3.005)+(9.003), (I-655)+(3.005)+(9.004), (I-655)+(3.005)+(9.005), (I-655)+(3.005)+(9.006), (I-655)+(3.005)+(9.007), (I-655)+(3.005)+(9.008), (I-655)+(3.005)+(9.009), (I-655)+(3.005)+(14.001), (I-655)+(3.005)+(14.002), (I-655)+(3.005)+(15.008), (I-655)+(3.005)+(15.011), (I-655)+(3.005)+(15.012), (I-655)+(3.005)+(15.016), (I-655)+(3.005)+(15.025), (I-655)+(3.005)+(15.027), (I-655)+(3.005)+(15.047), (I-655)+(3.005)+(15.063), (I-655)+(3.005)+(15.064), (I-655)+(3.005)+(16.001), (I-655)+(3.005)+(16.002), (I-655)+(3.005)+(16.003), (I-655)+(3.005)+(16.004), (I-655)+(3.005)+(16.005), (I-655)+(3.005)+(16.006), (I-655)+(3.005)+(16.007), (I-655)+(3.005)+(16.008), (I-655)+(3.005)+(17.001), (I-655)+(3.005)+(17.002), (I-655)+(3.005)+(17.003), (I-655)+(3.005)+(17.004), (I-655)+(3.005)+(17.005), (I-655)+(3.005)+(17.006), (I-655)+(3.005)+(17.007), (I-655)+(3.005)+(17.008), (I-655)+(3.005)+(17.009), (I-655)+(3.005)+(17.010), (I-655)+(3.005)+(17.011), (I-655)+(3.005)+(17.012), (I-655)+(3.005)+(18.001),

(I-655)+(3.006)+(3.025), (I-655)+(3.006)+(3.030), (I-655)+(3.006)+(3.031), (I-655)+(3.006)+(5.001), (I-655)+(3.006)+(5.002), (I-655)+(3.006)+(5.003), (I-655)+(3.006)+(5.004), (I-655)+(3.006)+(5.005), (I-655)+(3.006)+(5.006), (I-655)+(3.006)+(5.007), (I-655)+(3.006)+(5.008), (I-655)+(3.006)+(5.009), (I-655)+(3.006)+(5.010), (I-655)+(3.006)+(5.011), (I-655)+(3.006)+(5.012), (I-655)+(3.006)+(5.013), (I-655)+(3.006)+(5.014), (I-655)+(3.006)+(5.015), (I-655)+(3.006)+(5.016), (I-655)+(3.006)+(5.017), (I-655)+(3.006)+(5.018), (I-655)+(3.006)+(5.019), (I-655)+(3.006)+(5.020), (I-655)+(3.006)+(5.021), (I-655)+(3.006)+(5.022), (I-655)+(3.006)+(5.023), (I-655)+(3.006)+(6.001), (I-655)+(3.006)+(6.002), (I-655)+(3.006)+(6.003), (I-655)+(3.006)+(6.004), (I-655)+(3.006)+(7.001), (I-655)+(3.006)+(7.002), (I-655)+(3.006)+(7.003), (I-655)+(3.006)+(7.004), (I-655)+(3.006)+(7.005), (I-655)+(3.006)+(7.006), (I-655)+(3.006)+(9.001), (I-655)+(3.006)+(9.002), (I-655)+(3.006)+(9.003), (I-655)+(3.006)+(9.004), (I-655)+(3.006)+(9.005), (I-655)+(3.006)+(9.006), (I-655)+(3.006)+(9.007), (I-655)+(3.006)+(9.008), (I-655)+(3.006)+(9.009), (I-655)+(3.006)+(14.001), (I-655)+(3.006)+(14.002), (I-655)+(3.006)+(15.008), (I-655)+(3.006)+(15.011), (I-655)+(3.006)+(15.012), (I-655)+(3.006)+(15.016), (I-655)+(3.006)+(15.025), (I-655)+(3.006)+(15.027), (I-655)+(3.006)+(15.047), (I-655)+(3.006)+(15.063), (I-655)+(3.006)+(15.064), (I-655)+(3.006)+(16.001), (I-655)+(3.006)+(16.002), (I-655)+(3.006)+(16.003), (I-655)+(3.006)+(16.004), (I-655)+(3.006)+(16.005), (I-655)+(3.006)+(16.006), (I-655)+(3.006)+(16.007), (I-655)+(3.006)+(16.008), (I-655)+(3.006)+(17.001), (I-655)+(3.006)+(17.002), (I-655)+(3.006)+(17.003), (I-655)+(3.006)+(17.004), (I-655)+(3.006)+(17.005), (I-655)+(3.006)+(17.006), (I-655)+(3.006)+(17.007), (I-655)+(3.006)+(17.008), (I-655)+(3.006)+(17.009), (I-655)+(3.006)+(17.010), (I-655)+(3.006)+(17.011), (I-655)+(3.006)+(17.012), (I-655)+(3.006)+(18.001),

(I-655)+(3.007)+(3.025), (I-655)+(3.007)+(3.030), (I-655)+(3.007)+(3.031), (I-655)+(3.007)+(5.001), (I-655)+(3.007)+(5.002), (I-655)+(3.007)+(5.003), (I-655)+(3.007)+(5.004), (I-655)+(3.007)+(5.005), (I-655)+(3.007)+(5.006), (I-655)+(3.007)+(5.007), (I-655)+(3.007)+(5.008), (I-655)+(3.007)+(5.009), (I-655)+(3.007)+(5.010), (I-655)+(3.007)+(5.011), (I-655)+(3.007)+(5.012), (I-655)+(3.007)+(5.013), (I-655)+(3.007)+(5.014), (I-655)+(3.007)+(5.015), (I-655)+(3.007)+(5.016), (I-655)+(3.007)+(5.017), (I-655)+(3.007)+(5.018), (I-655)+(3.007)+(5.019), (I-655)+(3.007)+(5.020), (I-655)+(3.007)+(5.021), (I-655)+(3.007)+(5.022), (I-655)+(3.007)+(5.023), (I-655)+(3.007)+(6.001), (I-655)+(3.007)+(6.002), (I-655)+(3.007)+(6.003), (I-655)+(3.007)+(6.004), (I-655)+(3.007)+(7.001), (I-655)+(3.007)+(7.002), (I-655)+(3.007)+(7.003), (I-655)+(3.007)+(7.004), (I-655)+(3.007)+(7.005), (I-655)+(3.007)+(7.006), (I-655)+(3.007)+(9.001), (I-655)+(3.007)+(9.002), (I-655)+(3.007)+(9.003), (I-655)+(3.007)+(9.004), (I-655)+(3.007)+(9.005), (I-655)+(3.007)+(9.006), (I-655)+(3.007)+(9.007), (I-655)+(3.007)+(9.008), (I-655)+(3.007)+(9.009), (I-655)+(3.007)+(14.001), (I-655)+(3.007)+(14.002), (I-655)+(3.007)+(15.008), (I-655)+(3.007)+(15.011), (I-655)+(3.007)+(15.012), (I-655)+(3.007)+(15.016), (I-655)+(3.007)+(15.025), (I-655)+(3.007)+(15.027), (I-655)+(3.007)+(15.047), (I-655)+(3.007)+(15.063), (I-655)+(3.007)+(15.064), (I-655)+(3.007)+(16.001), (I-655)+(3.007)+(16.002), (I-655)+(3.007)+(16.003), (I-655)+(3.007)+(16.004), (I-655)+(3.007)+(16.005), (I-655)+(3.007)+(16.006), (I-655)+(3.007)+(16.007), (I-655)+(3.007)+(16.008), (I-655)+(3.007)+(17.001), (I-655)+(3.007)+(17.002), (I-655)+(3.007)+(17.003), (I-655)+(3.007)+(17.004), (I-655)+(3.007)+(17.005), (I-655)+(3.007)+(17.006), (I-655)+(3.007)+(17.007), (I-655)+(3.007)+(17.008), (I-655)+(3.007)+(17.009), (I-655)+(3.007)+(17.010), (I-655)+(3.007)+(17.011), (I-655)+(3.007)+(17.012), (I-655)+(3.007)+(18.001),

(I-655)+(3.008)+(3.025), (I-655)+(3.008)+(3.030), (I-655)+(3.008)+(3.031), (I-655)+(3.008)+(5.001), (I-655)+(3.008)+(5.002), (I-655)+(3.008)+(5.003), (I-655)+(3.008)+(5.004), (I-655)+(3.008)+(5.005), (I-655)+(3.008)+(5.006), (I-655)+(3.008)+(5.007), (I-655)+(3.008)+(5.008), (I-655)+(3.008)+(5.009), (I-655)+(3.008)+(5.010), (I-655)+(3.008)+(5.011), (I-655)+(3.008)+(5.012), (I-655)+(3.008)+(5.013), (I-655)+(3.008)+(5.014), (I-655)+(3.008)+(5.015), (I-655)+(3.008)+(5.016), (I-655)+(3.008)+(5.017), (I-655)+(3.008)+(5.018), (I-655)+(3.008)+(5.019), (I-655)+(3.008)+(5.020), (I-655)+(3.008)+(5.021), (I-655)+(3.008)+(5.022), (I-655)+(3.008)+(5.023), (I-655)+(3.008)+(6.001), (I-655)+(3.008)+(6.002), (I-655)+(3.008)+(6.003), (I-655)+(3.008)+(6.004), (I-655)+(3.008)+(7.001), (I-655)+(3.008)+(7.002), (I-655)+(3.008)+(7.003), (I-655)+(3.008)+(7.004), (I-655)+(3.008)+(7.005), (I-655)+(3.008)+(7.006), (I-655)+(3.008)+(9.001), (I-655)+(3.008)+(9.002), (I-655)+(3.008)+(9.003), (I-655)+(3.008)+(9.004), (I-655)+(3.008)+(9.005), (I-655)+(3.008)+(9.006), (I-655)+(3.008)+(9.007), (I-655)+(3.008)+(9.008), (I-655)+(3.008)+(9.009), (I-655)+(3.008)+(14.001), (I-655)+(3.008)+(14.002), (I-655)+(3.008)+(15.008), (I-655)+(3.008)+(15.011), (I-655)+(3.008)+(15.012), (I-655)+(3.008)+(15.016), (I-655)+(3.008)+(15.025), (I-655)+(3.008)+(15.027), (I-655)+(3.008)+(15.047), (I-655)+(3.008)+(15.063), (I-655)+(3.008)+(15.064), (I-655)+(3.008)+(16.001), (I-655)+(3.008)+(16.002), (I-655)+(3.008)+(16.003), (I-655)+(3.008)+(16.004), (I-655)+(3.008)+(16.005), (I-655)+(3.008)+(16.006), (I-655)+(3.008)+(16.007), (I-655)+(3.008)+(16.008), (I-655)+(3.008)+(17.001), (I-655)+(3.008)+(17.002), (I-655)+(3.008)+(17.003), (I-655)+(3.008)+(17.004), (I-655)+(3.008)+(17.005), (I-655)+(3.008)+(17.006), (I-655)+(3.008)+(17.007), (I-655)+(3.008)+(17.008), (I-655)+(3.008)+(17.009), (I-655)+(3.008)+(17.010), (I-655)+(3.008)+(17.011), (I-655)+(3.008)+(17.012), (I-655)+(3.008)+(18.001),

(I-655)+(3.009)+(3.025), (I-655)+(3.009)+(3.030), (I-655)+(3.009)+(3.031), (I-655)+(3.009)+(5.001), (I-655)+(3.009)+(5.002), (I-655)+(3.009)+(5.003), (I-655)+(3.009)+(5.004), (I-655)+(3.009)+(5.005), (I-655)+(3.009)+(5.006), (I-655)+(3.009)+(5.007), (I-655)+(3.009)+(5.008), (I-655)+(3.009)+(5.009), (I-655)+(3.009)+(5.010), (I-655)+(3.009)+(5.011), (I-655)+(3.009)+(5.012), (I-655)+(3.009)+(5.013), (I-655)+(3.009)+(5.014), (I-655)+(3.009)+(5.015), (I-655)+(3.009)+(5.016), (I-655)+(3.009)+(5.017), (I-655)+(3.009)+(5.018), (I-655)+(3.009)+(5.019), (I-655)+(3.009)+(5.020), (I-655)+(3.009)+(5.021), (I-655)+(3.009)+(5.022), (I-655)+(3.009)+(5.023), (I-655)+(3.009)+(6.001), (I-655)+(3.009)+(6.002), (I-655)+(3.009)+(6.003), (I-655)+(3.009)+(6.004), (I-655)+(3.009)+(7.001), (I-655)+(3.009)+(7.002), (I-655)+(3.009)+(7.003), (I-655)+(3.009)+(7.004), (I-655)+(3.009)+(7.005), (I-655)+(3.009)+(7.006), (I-655)+(3.009)+(9.001), (I-655)+(3.009)+(9.002), (I-655)+(3.009)+(9.003), (I-655)+(3.009)+(9.004), (I-655)+(3.009)+(9.005), (I-655)+(3.009)+(9.006), (I-655)+(3.009)+(9.007), (I-655)+(3.009)+(9.008), (I-655)+(3.009)+(9.009), (I-655)+(3.009)+(14.001), (I-655)+(3.009)+(14.002), (I-655)+(3.009)+(15.008), (I-655)+(3.009)+(15.011), (I-655)+(3.009)+(15.012), (I-655)+(3.009)+(15.016), (I-655)+(3.009)+(15.025), (I-655)+(3.009)+(15.027), (I-655)+(3.009)+(15.047), (I-655)+(3.009)+(15.063), (I-655)+(3.009)+(15.064), (I-655)+(3.009)+(16.001), (I-655)+(3.009)+(16.002), (I-655)+(3.009)+(16.003), (I-655)+(3.009)+(16.004), (I-655)+(3.009)+(16.005), (I-655)+(3.009)+(16.006), (I-655)+(3.009)+(16.007), (I-655)+(3.009)+(16.008), (I-655)+(3.009)+(17.001), (I-655)+(3.009)+(17.002), (I-655)+(3.009)+(17.003), (I-655)+(3.009)+(17.004), (I-655)+(3.009)+(17.005), (I-655)+(3.009)+(17.006), (I-655)+(3.009)+(17.007), (I-655)+(3.009)+(17.008), (I-655)+(3.009)+(17.009), (I-655)+(3.009)+(17.010), (I-655)+(3.009)+(17.011), (I-655)+(3.009)+(17.012), (I-655)+(3.009)+(18.001),

(I-655)+(3.010)+(3.025), (I-655)+(3.010)+(3.030), (I-655)+(3.010)+(3.031), (I-655)+(3.010)+(5.001), (I-655)+(3.010)+(5.002), (I-655)+(3.010)+(5.003), (I-655)+(3.010)+(5.004), (I-655)+(3.010)+(5.005), (I-655)+(3.010)+(5.006), (I-655)+(3.010)+(5.007), (I-655)+(3.010)+(5.008), (I-655)+(3.010)+(5.009), (I-655)+(3.010)+(5.010), (I-655)+(3.010)+(5.011), (I-655)+(3.010)+(5.012), (I-655)+(3.010)+(5.013), (I-655)+(3.010)+(5.014), (I-655)+(3.010)+(5.015), (I-655)+(3.010)+(5.016), (I-655)+(3.010)+(5.017), (I-655)+(3.010)+(5.018), (I-655)+(3.010)+(5.019), (I-655)+(3.010)+(5.020), (I-655)+(3.010)+(5.021), (I-655)+(3.010)+(5.022), (I-655)+(3.010)+(5.023), (I-655)+(3.010)+(6.001), (I-655)+(3.010)+(6.002), (I-655)+(3.010)+(6.003), (I-655)+(3.010)+(6.004), (I-655)+(3.010)+(7.001), (I-655)+(3.010)+(7.002), (I-655)+(3.010)+(7.003), (I-655)+(3.010)+(7.004), (I-655)+(3.010)+(7.005), (I-655)+(3.010)+(7.006), (I-655)+(3.010)+(9.001), (I-655)+(3.010)+(9.002), (I-655)+(3.010)+(9.003), (I-655)+(3.010)+(9.004), (I-655)+(3.010)+(9.005), (I-655)+(3.010)+(9.006), (I-655)+(3.010)+(9.007), (I-655)+(3.010)+(9.008), (I-655)+(3.010)+(9.009), (I-655)+(3.010)+(14.001), (I-655)+(3.010)+(14.002), (I-655)+(3.010)+(15.008), (I-655)+(3.010)+(15.011), (I-655)+(3.010)+(15.012), (I-655)+(3.010)+(15.016), (I-655)+(3.010)+(15.025), (I-655)+(3.010)+(15.027), (I-655)+(3.010)+(15.047), (I-655)+(3.010)+(15.063), (I-655)+(3.010)+(15.064), (I-655)+(3.010)+(16.001), (I-655)+(3.010)+(16.002), (I-655)+(3.010)+(16.003), (I-655)+(3.010)+(16.004), (I-655)+(3.010)+(16.005), (I-655)+(3.010)+(16.006), (I-655)+(3.010)+(16.007), (I-655)+(3.010)+(16.008), (I-655)+(3.010)+(17.001), (I-655)+(3.010)+(17.002), (I-655)+(3.010)+(17.003), (I-655)+(3.010)+(17.004), (I-655)+(3.010)+(17.005), (I-655)+(3.010)+(17.006), (I-655)+(3.010)+(17.007), (I-655)+(3.010)+(17.008), (I-655)+(3.010)+(17.009), (I-655)+(3.010)+(17.010), (I-655)+(3.010)+(17.011), (I-655)+(3.010)+(17.012), (I-655)+(3.010)+(18.001),

(I-655)+(3.011)+(3.025), (I-655)+(3.011)+(3.030), (I-655)+(3.011)+(3.031), (I-655)+(3.011)+(5.001), (I-655)+(3.011)+(5.002), (I-655)+(3.011)+(5.003), (I-655)+(3.011)+(5.004), (I-655)+(3.011)+(5.005), (I-655)+(3.011)+(5.006), (I-655)+(3.011)+(5.007), (I-655)+(3.011)+(5.008), (I-655)+(3.011)+(5.009), (I-655)+(3.011)+(5.010), (I-655)+(3.011)+(5.011), (I-655)+(3.011)+(5.012), (I-655)+(3.011)+(5.013), (I-655)+(3.011)+(5.014), (I-655)+(3.011)+(5.015), (I-655)+(3.011)+(5.016), (I-655)+(3.011)+(5.017), (I-655)+(3.011)+(5.018), (I-655)+(3.011)+(5.019), (I-655)+(3.011)+(5.020), (I-655)+(3.011)+(5.021), (I-655)+(3.011)+(5.022), (I-655)+(3.011)+(5.023), (I-655)+(3.011)+(6.001), (I-655)+(3.011)+(6.002), (I-655)+(3.011)+(6.003), (I-655)+(3.011)+(6.004), (I-655)+(3.011)+(7.001), (I-655)+(3.011)+(7.002), (I-655)+(3.011)+(7.003), (I-655)+(3.011)+(7.004), (I-655)+(3.011)+(7.005), (I-655)+(3.011)+(7.006), (I-655)+(3.011)+(9.001), (I-655)+(3.011)+(9.002), (I-655)+(3.011)+(9.003), (I-655)+(3.011)+(9.004), (I-655)+(3.011)+(9.005), (I-655)+(3.011)+(9.006), (I-655)+(3.011)+(9.007), (I-655)+(3.011)+(9.008), (I-655)+(3.011)+(9.009), (I-655)+(3.011)+(14.001), (I-655)+(3.011)+(14.002), (I-655)+(3.011)+(15.008), (I-655)+(3.011)+(15.011), (I-655)+(3.011)+(15.012), (I-655)+(3.011)+(15.016), (I-655)+(3.011)+(15.025), (I-655)+(3.011)+(15.027), (I-655)+(3.011)+(15.047), (I-655)+(3.011)+(15.063), (I-655)+(3.011)+(15.064), (I-655)+(3.011)+(16.001), (I-655)+(3.011)+(16.002), (I-655)+(3.011)+(16.003), (I-655)+(3.011)+(16.004), (I-655)+(3.011)+(16.005), (I-655)+(3.011)+(16.006), (I-655)+(3.011)+(16.007), (I-655)+(3.011)+(16.008), (I-655)+(3.011)+(17.001), (I-655)+(3.011)+(17.002), (I-655)+(3.011)+(17.003), (I-655)+(3.011)+(17.004), (I-655)+(3.011)+(17.005), (I-655)+(3.011)+(17.006), (I-655)+(3.011)+(17.007), (I-655)+(3.011)+(17.008), (I-655)+(3.011)+(17.009), (I-655)+(3.011)+(17.010), (I-655)+(3.011)+(17.011), (I-655)+(3.011)+(17.012), (I-655)+(3.011)+(18.001),

(I-655)+(3.012)+(3.025), (I-655)+(3.012)+(3.030), (I-655)+(3.012)+(3.031), (I-655)+(3.012)+(5.001), (I-655)+(3.012)+(5.002), (I-655)+(3.012)+(5.003), (I-655)+(3.012)+(5.004), (I-655)+(3.012)+(5.005), (I-655)+(3.012)+(5.006), (I-655)+(3.012)+(5.007), (I-655)+(3.012)+(5.008), (I-655)+(3.012)+(5.009), (I-655)+(3.012)+(5.010), (I-655)+(3.012)+(5.011), (I-655)+(3.012)+(5.012), (I-655)+(3.012)+(5.013), (I-655)+(3.012)+(5.014), (I-655)+(3.012)+(5.015), (I-655)+(3.012)+(5.016), (I-655)+(3.012)+(5.017), (I-655)+(3.012)+(5.018), (I-655)+(3.012)+(5.019), (I-655)+(3.012)+(5.020), (I-655)+(3.012)+(5.021), (I-655)+(3.012)+(5.022), (I-655)+(3.012)+(5.023), (I-655)+(3.012)+(6.001), (I-655)+(3.012)+(6.002), (I-655)+(3.012)+(6.003), (I-655)+(3.012)+(6.004), (I-655)+(3.012)+(7.001), (I-655)+(3.012)+(7.002), (I-655)+(3.012)+(7.003), (I-655)+(3.012)+(7.004), (I-655)+(3.012)+(7.005), (I-655)+(3.012)+(7.006), (I-655)+(3.012)+(9.001), (I-655)+(3.012)+(9.002), (I-655)+(3.012)+(9.003), (I-655)+(3.012)+(9.004), (I-655)+(3.012)+(9.005), (I-655)+(3.012)+(9.006), (I-655)+(3.012)+(9.007), (I-655)+(3.012)+(9.008), (I-655)+(3.012)+(9.009), (I-655)+(3.012)+(14.001), (I-655)+(3.012)+(14.002), (I-655)+(3.012)+(15.008), (I-655)+(3.012)+(15.011), (I-655)+(3.012)+(15.012), (I-655)+(3.012)+(15.016), (I-655)+(3.012)+(15.025), (I-655)+(3.012)+(15.027), (I-655)+(3.012)+(15.047), (I-655)+(3.012)+(15.063), (I-655)+(3.012)+(15.064), (I-655)+(3.012)+(16.001), (I-655)+(3.012)+(16.002), (I-655)+(3.012)+(16.003), (I-655)+(3.012)+(16.004), (I-655)+(3.012)+(16.005), (I-655)+(3.012)+(16.006), (I-655)+(3.012)+(16.007), (I-655)+(3.012)+(16.008), (I-655)+(3.012)+(17.001), (I-655)+(3.012)+(17.002), (I-655)+(3.012)+(17.003), (I-655)+(3.012)+(17.004), (I-655)+(3.012)+(17.005), (I-655)+(3.012)+(17.006), (I-655)+(3.012)+(17.007), (I-655)+(3.012)+(17.008), (I-655)+(3.012)+(17.009), (I-655)+(3.012)+(17.010), (I-655)+(3.012)+(17.011), (I-655)+(3.012)+(17.012), (I-655)+(3.012)+(18.001),

(I-655)+(3.013)+(3.025), (I-655)+(3.013)+(3.030), (I-655)+(3.013)+(3.031), (I-655)+(3.013)+(5.001), (I-655)+(3.013)+(5.002), (I-655)+(3.013)+(5.003), (I-655)+(3.013)+(5.004), (I-655)+(3.013)+(5.005), (I-655)+(3.013)+(5.006), (I-655)+(3.013)+(5.007), (I-655)+(3.013)+(5.008), (I-655)+(3.013)+(5.009), (I-655)+(3.013)+(5.010), (I-655)+(3.013)+(5.011), (I-655)+(3.013)+(5.012), (I-655)+(3.013)+(5.013), (I-655)+(3.013)+(5.014), (I-655)+(3.013)+(5.015), (I-655)+(3.013)+(5.016), (I-655)+(3.013)+(5.017), (I-655)+(3.013)+(5.018), (I-655)+(3.013)+(5.019), (I-655)+(3.013)+(5.020), (I-655)+(3.013)+(5.021), (I-655)+(3.013)+(5.022), (I-655)+(3.013)+(5.023), (I-655)+(3.013)+(6.001), (I-655)+(3.013)+(6.002), (I-655)+(3.013)+(6.003), (I-655)+(3.013)+(6.004), (I-655)+(3.013)+(7.001), (I-655)+(3.013)+(7.002), (I-655)+(3.013)+(7.003), (I-655)+(3.013)+(7.004), (I-655)+(3.013)+(7.005), (I-655)+(3.013)+(7.006), (I-655)+(3.013)+(9.001), (I-655)+(3.013)+(9.002), (I-655)+(3.013)+(9.003), (I-655)+(3.013)+(9.004), (I-655)+(3.013)+(9.005), (I-655)+(3.013)+(9.006), (I-655)+(3.013)+(9.007), (I-655)+(3.013)+(9.008), (I-655)+(3.013)+(9.009), (I-655)+(3.013)+(14.001), (I-655)+(3.013)+(14.002), (I-655)+(3.013)+(15.008), (I-655)+(3.013)+(15.011), (I-655)+(3.013)+(15.012), (I-655)+(3.013)+(15.016), (I-655)+(3.013)+(15.025), (I-655)+(3.013)+(15.027), (I-655)+(3.013)+(15.047), (I-655)+(3.013)+(15.063), (I-655)+(3.013)+(15.064), (I-655)+(3.013)+(16.001), (I-655)+(3.013)+(16.002), (I-655)+(3.013)+(16.003), (I-655)+(3.013)+(16.004), (I-655)+(3.013)+(16.005), (I-655)+(3.013)+(16.006), (I-655)+(3.013)+(16.007), (I-655)+(3.013)+(16.008), (I-655)+(3.013)+(17.001), (I-655)+(3.013)+(17.002), (I-655)+(3.013)+(17.003), (I-655)+(3.013)+(17.004), (I-655)+(3.013)+(17.005), (I-655)+(3.013)+(17.006), (I-655)+(3.013)+(17.007), (I-655)+(3.013)+(17.008), (I-655)+(3.013)+(17.009), (I-655)+(3.013)+(17.010), (I-655)+(3.013)+(17.011), (I-655)+(3.013)+(17.012), (I-655)+(3.013)+(18.001),

(I-655)+(3.014)+(3.025), (I-655)+(3.014)+(3.030), (I-655)+(3.014)+(3.031), (I-655)+(3.014)+(5.001), (I-655)+(3.014)+(5.002), (I-655)+(3.014)+(5.003), (I-655)+(3.014)+(5.004), (I-655)+(3.014)+(5.005), (I-655)+(3.014)+(5.006), (I-655)+(3.014)+(5.007), (I-655)+(3.014)+(5.008), (I-655)+(3.014)+(5.009), (I-655)+(3.014)+(5.010), (I-655)+(3.014)+(5.011), (I-655)+(3.014)+(5.012), (I-655)+(3.014)+(5.013), (I-655)+(3.014)+(5.014), (I-655)+(3.014)+(5.015), (I-655)+(3.014)+(5.016), (I-655)+(3.014)+(5.017), (I-655)+(3.014)+(5.018), (I-655)+(3.014)+(5.019), (I-655)+(3.014)+(5.020), (I-655)+(3.014)+(5.021), (I-655)+(3.014)+(5.022), (I-655)+(3.014)+(5.023), (I-655)+(3.014)+(6.001), (I-655)+(3.014)+(6.002), (I-655)+(3.014)+(6.003), (I-655)+(3.014)+(6.004), (I-655)+(3.014)+(7.001), (I-655)+(3.014)+(7.002), (I-655)+(3.014)+(7.003), (I-655)+(3.014)+(7.004), (I-655)+(3.014)+(7.005), (I-655)+(3.014)+(7.006), (I-655)+(3.014)+(9.001), (I-655)+(3.014)+(9.002), (I-655)+(3.014)+(9.003), (I-655)+(3.014)+(9.004), (I-655)+(3.014)+(9.005), (I-655)+(3.014)+(9.006), (I-655)+(3.014)+(9.007), (I-655)+(3.014)+(9.008), (I-655)+(3.014)+(9.009), (I-655)+(3.014)+(14.001), (I-655)+(3.014)+(14.002), (I-655)+(3.014)+(15.008), (I-655)+(3.014)+(15.011), (I-655)+(3.014)+(15.012), (I-655)+(3.014)+(15.016), (I-655)+(3.014)+(15.025), (I-655)+(3.014)+(15.027), (I-655)+(3.014)+(15.047), (I-655)+(3.014)+(15.063), (I-655)+(3.014)+(15.064), (I-655)+(3.014)+(16.001), (I-655)+(3.014)+(16.002), (I-655)+(3.014)+(16.003), (I-655)+(3.014)+(16.004), (I-655)+(3.014)+(16.005), (I-655)+(3.014)+(16.006), (I-655)+(3.014)+(16.007), (I-655)+(3.014)+(16.008), (I-655)+(3.014)+(17.001), (I-655)+(3.014)+(17.002), (I-655)+(3.014)+(17.003), (I-655)+(3.014)+(17.004), (I-655)+(3.014)+(17.005), (I-655)+(3.014)+(17.006), (I-655)+(3.014)+(17.007), (I-655)+(3.014)+(17.008), (I-655)+(3.014)+(17.009), (I-655)+(3.014)+(17.010), (I-655)+(3.014)+(17.011), (I-655)+(3.014)+(17.012), (I-655)+(3.014)+(18.001),

(I-655)+(3.015)+(3.025), (I-655)+(3.015)+(3.030), (I-655)+(3.015)+(3.031), (I-655)+(3.015)+(5.001), (I-655)+(3.015)+(5.002), (I-655)+(3.015)+(5.003), (I-655)+(3.015)+(5.004), (I-655)+(3.015)+(5.005), (I-655)+(3.015)+(5.006), (I-655)+(3.015)+(5.007), (I-655)+(3.015)+(5.008), (I-655)+(3.015)+(5.009), (I-655)+(3.015)+(5.010), (I-655)+(3.015)+(5.011), (I-655)+(3.015)+(5.012), (I-655)+(3.015)+(5.013), (I-655)+(3.015)+(5.014), (I-655)+(3.015)+(5.015), (I-655)+(3.015)+(5.016), (I-655)+(3.015)+(5.017), (I-655)+(3.015)+(5.018), (I-655)+(3.015)+(5.019), (I-655)+(3.015)+(5.020), (I-655)+(3.015)+(5.021), (I-655)+(3.015)+(5.022), (I-655)+(3.015)+(5.023), (I-655)+(3.015)+(6.001), (I-655)+(3.015)+(6.002), (I-655)+(3.015)+(6.003), (I-655)+(3.015)+(6.004), (I-655)+(3.015)+(7.001), (I-655)+(3.015)+(7.002), (I-655)+(3.015)+(7.003), (I-655)+(3.015)+(7.004), (I-655)+(3.015)+(7.005), (I-655)+(3.015)+(7.006), (I-655)+(3.015)+(9.001), (I-655)+(3.015)+(9.002), (I-655)+(3.015)+(9.003), (I-655)+(3.015)+(9.004), (I-655)+(3.015)+(9.005), (I-655)+(3.015)+(9.006), (I-655)+(3.015)+(9.007), (I-655)+(3.015)+(9.008), (I-655)+(3.015)+(9.009), (I-655)+(3.015)+(14.001), (I-655)+(3.015)+(14.002), (I-655)+(3.015)+(15.008), (I-655)+(3.015)+(15.011), (I-655)+(3.015)+(15.012), (I-655)+(3.015)+(15.016), (I-655)+(3.015)+(15.025), (I-655)+(3.015)+(15.027), (I-655)+(3.015)+(15.047), (I-655)+(3.015)+(15.063), (I-655)+(3.015)+(15.064), (I-655)+(3.015)+(16.001), (I-655)+(3.015)+(16.002), (I-655)+(3.015)+(16.003), (I-655)+(3.015)+(16.004), (I-655)+(3.015)+(16.005), (I-655)+(3.015)+(16.006), (I-655)+(3.015)+(16.007), (I-655)+(3.015)+(16.008), (I-655)+(3.015)+(17.001), (I-655)+(3.015)+(17.002), (I-655)+(3.015)+(17.003), (I-655)+(3.015)+(17.004), (I-655)+(3.015)+(17.005), (I-655)+(3.015)+(17.006), (I-655)+(3.015)+(17.007), (I-655)+(3.015)+(17.008), (I-655)+(3.015)+(17.009), (I-655)+(3.015)+(17.010), (I-655)+(3.015)+(17.011), (I-655)+(3.015)+(17.012), (I-655)+(3.015)+(18.001),

(I-655)+(3.016)+(3.025), (I-655)+(3.016)+(3.030), (I-655)+(3.016)+(3.031), (I-655)+(3.016)+(5.001), (I-655)+(3.016)+(5.002), (I-655)+(3.016)+(5.003), (I-655)+(3.016)+(5.004), (I-655)+(3.016)+(5.005), (I-655)+(3.016)+(5.006), (I-655)+(3.016)+(5.007), (I-655)+(3.016)+(5.008), (I-655)+(3.016)+(5.009), (I-655)+(3.016)+(5.010), (I-655)+(3.016)+(5.011), (I-655)+(3.016)+(5.012), (I-655)+(3.016)+(5.013), (I-655)+(3.016)+(5.014), (I-655)+(3.016)+(5.015), (I-655)+(3.016)+(5.016), (I-655)+(3.016)+(5.017), (I-655)+(3.016)+(5.018), (I-655)+(3.016)+(5.019), (I-655)+(3.016)+(5.020), (I-655)+(3.016)+(5.021), (I-655)+(3.016)+(5.022), (I-655)+(3.016)+(5.023), (I-655)+(3.016)+(6.001), (I-655)+(3.016)+(6.002), (I-655)+(3.016)+(6.003), (I-655)+(3.016)+(6.004), (I-655)+(3.016)+(7.001), (I-655)+(3.016)+(7.002), (I-655)+(3.016)+(7.003), (I-655)+(3.016)+(7.004), (I-655)+(3.016)+(7.005), (I-655)+(3.016)+(7.006), (I-655)+(3.016)+(9.001), (I-655)+(3.016)+(9.002), (I-655)+(3.016)+(9.003), (I-655)+(3.016)+(9.004), (I-655)+(3.016)+(9.005), (I-655)+(3.016)+(9.006), (I-655)+(3.016)+(9.007), (I-655)+(3.016)+(9.008), (I-655)+(3.016)+(9.009), (I-655)+(3.016)+(14.001), (I-655)+(3.016)+(14.002), (I-655)+(3.016)+(15.008), (I-655)+(3.016)+(15.011), (I-655)+(3.016)+(15.012), (I-655)+(3.016)+(15.016), (I-655)+(3.016)+(15.025), (I-655)+(3.016)+(15.027), (I-655)+(3.016)+(15.047), (I-655)+(3.016)+(15.063), (I-655)+(3.016)+(15.064), (I-655)+(3.016)+(16.001), (I-655)+(3.016)+(16.002), (I-655)+(3.016)+(16.003), (I-655)+(3.016)+(16.004), (I-655)+(3.016)+(16.005), (I-655)+(3.016)+(16.006), (I-655)+(3.016)+(16.007), (I-655)+(3.016)+(16.008), (I-655)+(3.016)+(17.001), (I-655)+(3.016)+(17.002), (I-655)+(3.016)+(17.003), (I-655)+(3.016)+(17.004), (I-655)+(3.016)+(17.005), (I-655)+(3.016)+(17.006), (I-655)+(3.016)+(17.007), (I-655)+(3.016)+(17.008), (I-655)+(3.016)+(17.009), (I-655)+(3.016)+(17.010), (I-655)+(3.016)+(17.011), (I-655)+(3.016)+(17.012), (I-655)+(3.016)+(18.001),

(I-655)+(3.017)+(3.025), (I-655)+(3.017)+(3.030), (I-655)+(3.017)+(3.031), (I-655)+(3.017)+(5.001), (I-655)+(3.017)+(5.002), (I-655)+(3.017)+(5.003), (I-655)+(3.017)+(5.004), (I-655)+(3.017)+(5.005), (I-655)+(3.017)+(5.006), (I-655)+(3.017)+(5.007), (I-655)+(3.017)+(5.008), (I-655)+(3.017)+(5.009), (I-655)+(3.017)+(5.010), (I-655)+(3.017)+(5.011), (I-655)+(3.017)+(5.012), (I-655)+(3.017)+(5.013), (I-655)+(3.017)+(5.014), (I-655)+(3.017)+(5.015), (I-655)+(3.017)+(5.016), (I-655)+(3.017)+(5.017), (I-655)+(3.017)+(5.018), (I-655)+(3.017)+(5.019), (I-655)+(3.017)+(5.020), (I-655)+(3.017)+(5.021), (I-655)+(3.017)+(5.022), (I-655)+(3.017)+(5.023), (I-655)+(3.017)+(6.001), (I-655)+(3.017)+(6.002), (I-655)+(3.017)+(6.003), (I-655)+(3.017)+(6.004), (I-655)+(3.017)+(7.001), (I-655)+(3.017)+(7.002), (I-655)+(3.017)+(7.003), (I-655)+(3.017)+(7.004), (I-655)+(3.017)+(7.005), (I-655)+(3.017)+(7.006), (I-655)+(3.017)+(9.001), (I-655)+(3.017)+(9.002), (I-655)+(3.017)+(9.003), (I-655)+(3.017)+(9.004), (I-655)+(3.017)+(9.005), (I-655)+(3.017)+(9.006), (I-655)+(3.017)+(9.007), (I-655)+(3.017)+(9.008), (I-655)+(3.017)+(9.009), (I-655)+(3.017)+(14.001), (I-655)+(3.017)+(14.002), (I-655)+(3.017)+(15.008), (I-655)+(3.017)+(15.011), (I-655)+(3.017)+(15.012), (I-655)+(3.017)+(15.016), (I-655)+(3.017)+(15.025), (I-655)+(3.017)+(15.027), (I-655)+(3.017)+(15.047), (I-655)+(3.017)+(15.063), (I-655)+(3.017)+(15.064), (I-655)+(3.017)+(16.001), (I-655)+(3.017)+(16.002), (I-655)+(3.017)+(16.003), (I-655)+(3.017)+(16.004), (I-655)+(3.017)+(16.005), (I-655)+(3.017)+(16.006), (I-655)+(3.017)+(16.007), (I-655)+(3.017)+(16.008), (I-655)+(3.017)+(17.001), (I-655)+(3.017)+(17.002), (I-655)+(3.017)+(17.003), (I-655)+(3.017)+(17.004), (I-655)+(3.017)+(17.005), (I-655)+(3.017)+(17.006), (I-655)+(3.017)+(17.007), (I-655)+(3.017)+(17.008), (I-655)+(3.017)+(17.009), (I-655)+(3.017)+(17.010), (I-655)+(3.017)+(17.011), (I-655)+(3.017)+(17.012), (I-655)+(3.017)+(18.001),

(I-655)+(3.018)+(3.025), (I-655)+(3.018)+(3.030), (I-655)+(3.018)+(3.031), (I-655)+(3.018)+(5.001), (I-655)+(3.018)+(5.002), (I-655)+(3.018)+(5.003), (I-655)+(3.018)+(5.004), (I-655)+(3.018)+(5.005), (I-655)+(3.018)+(5.006), (I-655)+(3.018)+(5.007), (I-655)+(3.018)+(5.008), (I-655)+(3.018)+(5.009), (I-655)+(3.018)+(5.010), (I-655)+(3.018)+(5.011), (I-655)+(3.018)+(5.012), (I-655)+(3.018)+(5.013), (I-655)+(3.018)+(5.014), (I-655)+(3.018)+(5.015), (I-655)+(3.018)+(5.016), (I-655)+(3.018)+(5.017), (I-655)+(3.018)+(5.018), (I-655)+(3.018)+(5.019), (I-655)+(3.018)+(5.020), (I-655)+(3.018)+(5.021), (I-655)+(3.018)+(5.022), (I-655)+(3.018)+(5.023), (I-655)+(3.018)+(6.001), (I-655)+(3.018)+(6.002), (I-655)+(3.018)+(6.003), (I-655)+(3.018)+(6.004), (I-655)+(3.018)+(7.001), (I-655)+(3.018)+(7.002), (I-655)+(3.018)+(7.003), (I-655)+(3.018)+(7.004), (I-655)+(3.018)+(7.005), (I-655)+(3.018)+(7.006), (I-655)+(3.018)+(9.001), (I-655)+(3.018)+(9.002), (I-655)+(3.018)+(9.003), (I-655)+(3.018)+(9.004), (I-655)+(3.018)+(9.005), (I-655)+(3.018)+(9.006), (I-655)+(3.018)+(9.007), (I-655)+(3.018)+(9.008), (I-655)+(3.018)+(9.009), (I-655)+(3.018)+(14.001), (I-655)+(3.018)+(14.002), (I-655)+(3.018)+(15.008), (I-655)+(3.018)+(15.011), (I-655)+(3.018)+(15.012), (I-655)+(3.018)+(15.016), (I-655)+(3.018)+(15.025), (I-655)+(3.018)+(15.027), (I-655)+(3.018)+(15.047), (I-655)+(3.018)+(15.063), (I-655)+(3.018)+(15.064), (I-655)+(3.018)+(16.001), (I-655)+(3.018)+(16.002), (I-655)+(3.018)+(16.003), (I-655)+(3.018)+(16.004), (I-655)+(3.018)+(16.005), (I-655)+(3.018)+(16.006), (I-655)+(3.018)+(16.007), (I-655)+(3.018)+(16.008), (I-655)+(3.018)+(17.001), (I-655)+(3.018)+(17.002), (I-655)+(3.018)+(17.003), (I-655)+(3.018)+(17.004), (I-655)+(3.018)+(17.005), (I-655)+(3.018)+(17.006), (I-655)+(3.018)+(17.007), (I-655)+(3.018)+(17.008), (I-655)+(3.018)+(17.009), (I-655)+(3.018)+(17.010), (I-655)+(3.018)+(17.011), (I-655)+(3.018)+(17.012), (I-655)+(3.018)+(18.001),

(I-655)+(3.019)+(3.025), (I-655)+(3.019)+(3.030), (I-655)+(3.019)+(3.031), (I-655)+(3.019)+(5.001), (I-655)+(3.019)+(5.002), (I-655)+(3.019)+(5.003), (I-655)+(3.019)+(5.004), (I-655)+(3.019)+(5.005), (I-655)+(3.019)+(5.006), (I-655)+(3.019)+(5.007), (I-655)+(3.019)+(5.008), (I-655)+(3.019)+(5.009), (I-655)+(3.019)+(5.010), (I-655)+(3.019)+(5.011), (I-655)+(3.019)+(5.012), (I-655)+(3.019)+(5.013), (I-655)+(3.019)+(5.014), (I-655)+(3.019)+(5.015), (I-655)+(3.019)+(5.016), (I-655)+(3.019)+(5.017), (I-655)+(3.019)+(5.018), (I-655)+(3.019)+(5.019), (I-655)+(3.019)+(5.020), (I-655)+(3.019)+(5.021), (I-655)+(3.019)+(5.022), (I-655)+(3.019)+(5.023), (I-655)+(3.019)+(6.001), (I-655)+(3.019)+(6.002), (I-655)+(3.019)+(6.003), (I-655)+(3.019)+(6.004), (I-655)+(3.019)+(7.001), (I-655)+(3.019)+(7.002), (I-655)+(3.019)+(7.003), (I-655)+(3.019)+(7.004), (I-655)+(3.019)+(7.005), (I-655)+(3.019)+(7.006), (I-655)+(3.019)+(9.001), (I-655)+(3.019)+(9.002), (I-655)+(3.019)+(9.003), (I-655)+(3.019)+(9.004), (I-655)+(3.019)+(9.005), (I-655)+(3.019)+(9.006), (I-655)+(3.019)+(9.007), (I-655)+(3.019)+(9.008), (I-655)+(3.019)+(9.009), (I-655)+(3.019)+(14.001), (I-655)+(3.019)+(14.002), (I-655)+(3.019)+(15.008), (I-655)+(3.019)+(15.011), (I-655)+(3.019)+(15.012), (I-655)+(3.019)+(15.016), (I-655)+(3.019)+(15.025), (I-655)+(3.019)+(15.027), (I-655)+(3.019)+(15.047), (I-655)+(3.019)+(15.063), (I-655)+(3.019)+(15.064), (I-655)+(3.019)+(16.001), (I-655)+(3.019)+(16.002), (I-655)+(3.019)+(16.003), (I-655)+(3.019)+(16.004), (I-655)+(3.019)+(16.005), (I-655)+(3.019)+(16.006), (I-655)+(3.019)+(16.007), (I-655)+(3.019)+(16.008), (I-655)+(3.019)+(17.001), (I-655)+(3.019)+(17.002), (I-655)+(3.019)+(17.003), (I-655)+(3.019)+(17.004), (I-655)+(3.019)+(17.005), (I-655)+(3.019)+(17.006), (I-655)+(3.019)+(17.007), (I-655)+(3.019)+(17.008), (I-655)+(3.019)+(17.009), (I-655)+(3.019)+(17.010), (I-655)+(3.019)+(17.011), (I-655)+(3.019)+(17.012), (I-655)+(3.019)+(18.001),

(I-655)+(3.020)+(3.025), (I-655)+(3.020)+(3.030), (I-655)+(3.020)+(3.031), (I-655)+(3.020)+(5.001), (I-655)+(3.020)+(5.002), (I-655)+(3.020)+(5.003), (I-655)+(3.020)+(5.004), (I-655)+(3.020)+(5.005), (I-655)+(3.020)+(5.006), (I-655)+(3.020)+(5.007), (I-655)+(3.020)+(5.008), (I-655)+(3.020)+(5.009), (I-655)+(3.020)+(5.010), (I-655)+(3.020)+(5.011), (I-655)+(3.020)+(5.012), (I-655)+(3.020)+(5.013), (I-655)+(3.020)+(5.014), (I-655)+(3.020)+(5.015), (I-655)+(3.020)+(5.016), (I-655)+(3.020)+(5.017), (I-655)+(3.020)+(5.018), (I-655)+(3.020)+(5.019), (I-655)+(3.020)+(5.020), (I-655)+(3.020)+(5.021), (I-655)+(3.020)+(5.022), (I-655)+(3.020)+(5.023), (I-655)+(3.020)+(6.001), (I-655)+(3.020)+(6.002), (I-655)+(3.020)+(6.003), (I-655)+(3.020)+(6.004), (I-655)+(3.020)+(7.001), (I-655)+(3.020)+(7.002), (I-655)+(3.020)+(7.003), (I-655)+(3.020)+(7.004), (I-655)+(3.020)+(7.005), (I-655)+(3.020)+(7.006), (I-655)+(3.020)+(9.001), (I-655)+(3.020)+(9.002), (I-655)+(3.020)+(9.003), (I-655)+(3.020)+(9.004), (I-655)+(3.020)+(9.005), (I-655)+(3.020)+(9.006), (I-655)+(3.020)+(9.007), (I-655)+(3.020)+(9.008), (I-655)+(3.020)+(9.009), (I-655)+(3.020)+(14.001), (I-655)+(3.020)+(14.002), (I-655)+(3.020)+(15.008), (I-655)+(3.020)+(15.011), (I-655)+(3.020)+(15.012), (I-655)+(3.020)+(15.016), (I-655)+(3.020)+(15.025), (I-655)+(3.020)+(15.027), (I-655)+(3.020)+(15.047), (I-655)+(3.020)+(15.063), (I-655)+(3.020)+(15.064), (I-655)+(3.020)+(16.001), (I-655)+(3.020)+(16.002), (I-655)+(3.020)+(16.003), (I-655)+(3.020)+(16.004), (I-655)+(3.020)+(16.005), (I-655)+(3.020)+(16.006), (I-655)+(3.020)+(16.007), (I-655)+(3.020)+(16.008), (I-655)+(3.020)+(17.001), (I-655)+(3.020)+(17.002), (I-655)+(3.020)+(17.003), (I-655)+(3.020)+(17.004), (I-655)+(3.020)+(17.005), (I-655)+(3.020)+(17.006), (I-655)+(3.020)+(17.007), (I-655)+(3.020)+(17.008), (I-655)+(3.020)+(17.009), (I-655)+(3.020)+(17.010), (I-655)+(3.020)+(17.011), (I-655)+(3.020)+(17.012), (I-655)+(3.020)+(18.001),

(I-655)+(3.021)+(3.025), (I-655)+(3.021)+(3.030), (I-655)+(3.021)+(3.031), (I-655)+(3.021)+(5.001), (I-655)+(3.021)+(5.002), (I-655)+(3.021)+(5.003), (I-655)+(3.021)+(5.004), (I-655)+(3.021)+(5.005), (I-655)+(3.021)+(5.006), (I-655)+(3.021)+(5.007), (I-655)+(3.021)+(5.008), (I-655)+(3.021)+(5.009), (I-655)+(3.021)+(5.010), (I-655)+(3.021)+(5.011), (I-655)+(3.021)+(5.012), (I-655)+(3.021)+(5.013), (I-655)+(3.021)+(5.014), (I-655)+(3.021)+(5.015), (I-655)+(3.021)+(5.016), (I-655)+(3.021)+(5.017), (I-655)+(3.021)+(5.018), (I-655)+(3.021)+(5.019), (I-655)+(3.021)+(5.020), (I-655)+(3.021)+(5.021), (I-655)+(3.021)+(5.022), (I-655)+(3.021)+(5.023), (I-655)+(3.021)+(6.001), (I-655)+(3.021)+(6.002), (I-655)+(3.021)+(6.003), (I-655)+(3.021)+(6.004), (I-655)+(3.021)+(7.001), (I-655)+(3.021)+(7.002), (I-655)+(3.021)+(7.003), (I-655)+(3.021)+(7.004), (I-655)+(3.021)+(7.005), (I-655)+(3.021)+(7.006), (I-655)+(3.021)+(9.001), (I-655)+(3.021)+(9.002), (I-655)+(3.021)+(9.003), (I-655)+(3.021)+(9.004), (I-655)+(3.021)+(9.005), (I-655)+(3.021)+(9.006), (I-655)+(3.021)+(9.007), (I-655)+(3.021)+(9.008), (I-655)+(3.021)+(9.009), (I-655)+(3.021)+(14.001), (I-655)+(3.021)+(14.002), (I-655)+(3.021)+(15.008), (I-655)+(3.021)+(15.011), (I-655)+(3.021)+(15.012), (I-655)+(3.021)+(15.016), (I-655)+(3.021)+(15.025), (I-655)+(3.021)+(15.027), (I-655)+(3.021)+(15.047), (I-655)+(3.021)+(15.063), (I-655)+(3.021)+(15.064), (I-655)+(3.021)+(16.001), (I-655)+(3.021)+(16.002), (I-655)+(3.021)+(16.003), (I-655)+(3.021)+(16.004), (I-655)+(3.021)+(16.005), (I-655)+(3.021)+(16.006), (I-655)+(3.021)+(16.007), (I-655)+(3.021)+(16.008), (I-655)+(3.021)+(17.001), (I-655)+(3.021)+(17.002), (I-655)+(3.021)+(17.003), (I-655)+(3.021)+(17.004), (I-655)+(3.021)+(17.005), (I-655)+(3.021)+(17.006), (I-655)+(3.021)+(17.007), (I-655)+(3.021)+(17.008), (I-655)+(3.021)+(17.009), (I-655)+(3.021)+(17.010), (I-655)+(3.021)+(17.011), (I-655)+(3.021)+(17.012), (I-655)+(3.021)+(18.001),

(I-655)+(3.022)+(3.025), (I-655)+(3.022)+(3.030), (I-655)+(3.022)+(3.031), (I-655)+(3.022)+(5.001), (I-655)+(3.022)+(5.002), (I-655)+(3.022)+(5.003), (I-655)+(3.022)+(5.004), (I-655)+(3.022)+(5.005), (I-655)+(3.022)+(5.006), (I-655)+(3.022)+(5.007), (I-655)+(3.022)+(5.008), (I-655)+(3.022)+(5.009), (I-655)+(3.022)+(5.010), (I-655)+(3.022)+(5.011), (I-655)+(3.022)+(5.012), (I-655)+(3.022)+(5.013), (I-655)+(3.022)+(5.014), (I-655)+(3.022)+(5.015), (I-655)+(3.022)+(5.016), (I-655)+(3.022)+(5.017), (I-655)+(3.022)+(5.018), (I-655)+(3.022)+(5.019), (I-655)+(3.022)+(5.020), (I-655)+(3.022)+(5.021), (I-655)+(3.022)+(5.022), (I-655)+(3.022)+(5.023), (I-655)+(3.022)+(6.001), (I-655)+(3.022)+(6.002), (I-655)+(3.022)+(6.003), (I-655)+(3.022)+(6.004), (I-655)+(3.022)+(7.001), (I-655)+(3.022)+(7.002), (I-655)+(3.022)+(7.003), (I-655)+(3.022)+(7.004), (I-655)+(3.022)+(7.005), (I-655)+(3.022)+(7.006), (I-655)+(3.022)+(9.001), (I-655)+(3.022)+(9.002), (I-655)+(3.022)+(9.003), (I-655)+(3.022)+(9.004), (I-655)+(3.022)+(9.005), (I-655)+(3.022)+(9.006), (I-655)+(3.022)+(9.007), (I-655)+(3.022)+(9.008), (I-655)+(3.022)+(9.009), (I-655)+(3.022)+(14.001), (I-655)+(3.022)+(14.002), (I-655)+(3.022)+(15.008), (I-655)+(3.022)+(15.011), (I-655)+(3.022)+(15.012), (I-655)+(3.022)+(15.016), (I-655)+(3.022)+(15.025), (I-655)+(3.022)+(15.027), (I-655)+(3.022)+(15.047), (I-655)+(3.022)+(15.063), (I-655)+(3.022)+(15.064), (I-655)+(3.022)+(16.001), (I-655)+(3.022)+(16.002), (I-655)+(3.022)+(16.003), (I-655)+(3.022)+(16.004), (I-655)+(3.022)+(16.005), (I-655)+(3.022)+(16.006), (I-655)+(3.022)+(16.007), (I-655)+(3.022)+(16.008), (I-655)+(3.022)+(17.001), (I-655)+(3.022)+(17.002), (I-655)+(3.022)+(17.003), (I-655)+(3.022)+(17.004), (I-655)+(3.022)+(17.005), (I-655)+(3.022)+(17.006), (I-655)+(3.022)+(17.007), (I-655)+(3.022)+(17.008), (I-655)+(3.022)+(17.009), (I-655)+(3.022)+(17.010), (I-655)+(3.022)+(17.011), (I-655)+(3.022)+(17.012), (I-655)+(3.022)+(18.001),

(I-655)+(3.023)+(3.025), (I-655)+(3.023)+(3.030), (I-655)+(3.023)+(3.031), (I-655)+(3.023)+(5.001), (I-655)+(3.023)+(5.002), (I-655)+(3.023)+(5.003), (I-655)+(3.023)+(5.004), (I-655)+(3.023)+(5.005), (I-655)+(3.023)+(5.006), (I-655)+(3.023)+(5.007), (I-655)+(3.023)+(5.008), (I-655)+(3.023)+(5.009), (I-655)+(3.023)+(5.010), (I-655)+(3.023)+(5.011), (I-655)+(3.023)+(5.012), (I-655)+(3.023)+(5.013), (I-655)+(3.023)+(5.014), (I-655)+(3.023)+(5.015), (I-655)+(3.023)+(5.016), (I-655)+(3.023)+(5.017), (I-655)+(3.023)+(5.018), (I-655)+(3.023)+(5.019), (I-655)+(3.023)+(5.020), (I-655)+(3.023)+(5.021), (I-655)+(3.023)+(5.022), (I-655)+(3.023)+(5.023), (I-655)+(3.023)+(6.001), (I-655)+(3.023)+(6.002), (I-655)+(3.023)+(6.003), (I-655)+(3.023)+(6.004), (I-655)+(3.023)+(7.001), (I-655)+(3.023)+(7.002), (I-655)+(3.023)+(7.003), (I-655)+(3.023)+(7.004), (I-655)+(3.023)+(7.005), (I-655)+(3.023)+(7.006), (I-655)+(3.023)+(9.001), (I-655)+(3.023)+(9.002), (I-655)+(3.023)+(9.003), (I-655)+(3.023)+(9.004), (I-655)+(3.023)+(9.005), (I-655)+(3.023)+(9.006), (I-655)+(3.023)+(9.007), (I-655)+(3.023)+(9.008), (I-655)+(3.023)+(9.009), (I-655)+(3.023)+(14.001), (I-655)+(3.023)+(14.002), (I-655)+(3.023)+(15.008), (I-655)+(3.023)+(15.011), (I-655)+(3.023)+(15.012), (I-655)+(3.023)+(15.016), (I-655)+(3.023)+(15.025), (I-655)+(3.023)+(15.027), (I-655)+(3.023)+(15.047), (I-655)+(3.023)+(15.063), (I-655)+(3.023)+(15.064), (I-655)+(3.023)+(16.001), (I-655)+(3.023)+(16.002), (I-655)+(3.023)+(16.003), (I-655)+(3.023)+(16.004), (I-655)+(3.023)+(16.005), (I-655)+(3.023)+(16.006), (I-655)+(3.023)+(16.007), (I-655)+(3.023)+(16.008), (I-655)+(3.023)+(17.001), (I-655)+(3.023)+(17.002), (I-655)+(3.023)+(17.003), (I-655)+(3.023)+(17.004), (I-655)+(3.023)+(17.005), (I-655)+(3.023)+(17.006), (I-655)+(3.023)+(17.007), (I-655)+(3.023)+(17.008), (I-655)+(3.023)+(17.009), (I-655)+(3.023)+(17.010), (I-655)+(3.023)+(17.011), (I-655)+(3.023)+(17.012), (I-655)+(3.023)+(18.001),

(I-655)+(3.024)+(3.025), (I-655)+(3.024)+(3.030), (I-655)+(3.024)+(3.031), (I-655)+(3.024)+(5.001), (I-655)+(3.024)+(5.002), (I-655)+(3.024)+(5.003), (I-655)+(3.024)+(5.004), (I-655)+(3.024)+(5.005), (I-655)+(3.024)+(5.006), (I-655)+(3.024)+(5.007), (I-655)+(3.024)+(5.008), (I-655)+(3.024)+(5.009), (I-655)+(3.024)+(5.010), (I-655)+(3.024)+(5.011), (I-655)+(3.024)+(5.012), (I-655)+(3.024)+(5.013), (I-655)+(3.024)+(5.014), (I-655)+(3.024)+(5.015), (I-655)+(3.024)+(5.016), (I-655)+(3.024)+(5.017), (I-655)+(3.024)+(5.018), (I-655)+(3.024)+(5.019), (I-655)+(3.024)+(5.020), (I-655)+(3.024)+(5.021), (I-655)+(3.024)+(5.022), (I-655)+(3.024)+(5.023), (I-655)+(3.024)+(6.001), (I-655)+(3.024)+(6.002), (I-655)+(3.024)+(6.003), (I-655)+(3.024)+(6.004), (I-655)+(3.024)+(7.001), (I-655)+(3.024)+(7.002), (I-655)+(3.024)+(7.003), (I-655)+(3.024)+(7.004), (I-655)+(3.024)+(7.005), (I-655)+(3.024)+(7.006), (I-655)+(3.024)+(9.001), (I-655)+(3.024)+(9.002), (I-655)+(3.024)+(9.003), (I-655)+(3.024)+(9.004), (I-655)+(3.024)+(9.005), (I-655)+(3.024)+(9.006), (I-655)+(3.024)+(9.007), (I-655)+(3.024)+(9.008), (I-655)+(3.024)+(9.009), (I-655)+(3.024)+(14.001), (I-655)+(3.024)+(14.002), (I-655)+(3.024)+(15.008), (I-655)+(3.024)+(15.011), (I-655)+(3.024)+(15.012), (I-655)+(3.024)+(15.016), (I-655)+(3.024)+(15.025), (I-655)+(3.024)+(15.027), (I-655)+(3.024)+(15.047), (I-655)+(3.024)+(15.063), (I-655)+(3.024)+(15.064), (I-655)+(3.024)+(16.001), (I-655)+(3.024)+(16.002), (I-655)+(3.024)+(16.003), (I-655)+(3.024)+(16.004), (I-655)+(3.024)+(16.005), (I-655)+(3.024)+(16.006), (I-655)+(3.024)+(16.007), (I-655)+(3.024)+(16.008), (I-655)+(3.024)+(17.001), (I-655)+(3.024)+(17.002), (I-655)+(3.024)+(17.003), (I-655)+(3.024)+(17.004), (I-655)+(3.024)+(17.005), (I-655)+(3.024)+(17.006), (I-655)+(3.024)+(17.007), (I-655)+(3.024)+(17.008), (I-655)+(3.024)+(17.009), (I-655)+(3.024)+(17.010), (I-655)+(3.024)+(17.011), (I-655)+(3.024)+(17.012), (I-655)+(3.024)+(18.001),

(I-655)+(3.025)+(3.030), (I-655)+(3.025)+(3.031), (I-655)+(3.025)+(5.001), (I-655)+(3.025)+(5.002), (I-655)+(3.025)+(5.003), (I-655)+(3.025)+(5.004), (I-655)+(3.025)+(5.005), (I-655)+(3.025)+(5.006), (I-655)+(3.025)+(5.007), (I-655)+(3.025)+(5.008), (I-655)+(3.025)+(5.009), (I-655)+(3.025)+(5.010), (I-655)+(3.025)+(5.011), (I-655)+(3.025)+(5.012), (I-655)+(3.025)+(5.013), (I-655)+(3.025)+(5.014), (I-655)+(3.025)+(5.015), (I-655)+(3.025)+(5.016), (I-655)+(3.025)+(5.017), (I-655)+(3.025)+(5.018), (I-655)+(3.025)+(5.019), (I-655)+(3.025)+(5.020), (I-655)+(3.025)+(5.021), (I-655)+(3.025)+(5.022), (I-655)+(3.025)+(5.023), (I-655)+(3.025)+(6.001), (I-655)+(3.025)+(6.002), (I-655)+(3.025)+(6.003), (I-655)+(3.025)+(6.004), (I-655)+(3.025)+(7.001), (I-655)+(3.025)+(7.002), (I-655)+(3.025)+(7.003), (I-655)+(3.025)+(7.004), (I-655)+(3.025)+(7.005), (I-655)+(3.025)+(7.006), (I-655)+(3.025)+(9.001), (I-655)+(3.025)+(9.002), (I-655)+(3.025)+(9.003), (I-655)+(3.025)+(9.004), (I-655)+(3.025)+(9.005), (I-655)+(3.025)+(9.006), (I-655)+(3.025)+(9.007), (I-655)+(3.025)+(9.008), (I-655)+(3.025)+(9.009), (I-655)+(3.025)+(14.001), (I-655)+(3.025)+(14.002), (I-655)+(3.025)+(15.008), (I-655)+(3.025)+(15.011), (I-655)+(3.025)+(15.012), (I-655)+(3.025)+(15.016), (I-655)+(3.025)+(15.025), (I-655)+(3.025)+(15.027), (I-655)+(3.025)+(15.047), (I-655)+(3.025)+(15.063), (I-655)+(3.025)+(15.064), (I-655)+(3.025)+(16.001), (I-655)+(3.025)+(16.002), (I-655)+(3.025)+(16.003), (I-655)+(3.025)+(16.004), (I-655)+(3.025)+(16.005), (I-655)+(3.025)+(16.006), (I-655)+(3.025)+(16.007), (I-655)+(3.025)+(16.008), (I-655)+(3.025)+(17.001), (I-655)+(3.025)+(17.002), (I-655)+(3.025)+(17.003), (I-655)+(3.025)+(17.004), (I-655)+(3.025)+(17.005), (I-655)+(3.025)+(17.006), (I-655)+(3.025)+(17.007), (I-655)+(3.025)+(17.008), (I-655)+(3.025)+(17.009), (I-655)+(3.025)+(17.010), (I-655)+(3.025)+(17.011), (I-655)+(3.025)+(17.012), (I-655)+(3.025)+(18.001),

(I-655)+(3.026)+(3.025), (I-655)+(3.026)+(3.030), (I-655)+(3.026)+(3.031), (I-655)+(3.026)+(5.001), (I-655)+(3.026)+(5.002), (I-655)+(3.026)+(5.003), (I-655)+(3.026)+(5.004), (I-655)+(3.026)+(5.005), (I-655)+(3.026)+(5.006), (I-655)+(3.026)+(5.007), (I-655)+(3.026)+(5.008), (I-655)+(3.026)+(5.009), (I-655)+(3.026)+(5.010), (I-655)+(3.026)+(5.011), (I-655)+(3.026)+(5.012), (I-655)+(3.026)+(5.013), (I-655)+(3.026)+(5.014), (I-655)+(3.026)+(5.015), (I-655)+(3.026)+(5.016), (I-655)+(3.026)+(5.017), (I-655)+(3.026)+(5.018), (I-655)+(3.026)+(5.019), (I-655)+(3.026)+(5.020), (I-655)+(3.026)+(5.021), (I-655)+(3.026)+(5.022), (I-655)+(3.026)+(5.023), (I-655)+(3.026)+(6.001), (I-655)+(3.026)+(6.002), (I-655)+(3.026)+(6.003), (I-655)+(3.026)+(6.004), (I-655)+(3.026)+(7.001), (I-655)+(3.026)+(7.002), (I-655)+(3.026)+(7.003), (I-655)+(3.026)+(7.004), (I-655)+(3.026)+(7.005), (I-655)+(3.026)+(7.006), (I-655)+(3.026)+(9.001), (I-655)+(3.026)+(9.002), (I-655)+(3.026)+(9.003), (I-655)+(3.026)+(9.004), (I-655)+(3.026)+(9.005), (I-655)+(3.026)+(9.006), (I-655)+(3.026)+(9.007), (I-655)+(3.026)+(9.008), (I-655)+(3.026)+(9.009), (I-655)+(3.026)+(14.001), (I-655)+(3.026)+(14.002), (I-655)+(3.026)+(15.008), (I-655)+(3.026)+(15.011), (I-655)+(3.026)+(15.012), (I-655)+(3.026)+(15.016), (I-655)+(3.026)+(15.025), (I-655)+(3.026)+(15.027), (I-655)+(3.026)+(15.047), (I-655)+(3.026)+(15.063), (I-655)+(3.026)+(15.064), (I-655)+(3.026)+(16.001), (I-655)+(3.026)+(16.002), (I-655)+(3.026)+(16.003), (I-655)+(3.026)+(16.004), (I-655)+(3.026)+(16.005), (I-655)+(3.026)+(16.006), (I-655)+(3.026)+(16.007), (I-655)+(3.026)+(16.008), (I-655)+(3.026)+(17.001), (I-655)+(3.026)+(17.002), (I-655)+(3.026)+(17.003), (I-655)+(3.026)+(17.004), (I-655)+(3.026)+(17.005), (I-655)+(3.026)+(17.006), (I-655)+(3.026)+(17.007), (I-655)+(3.026)+(17.008), (I-655)+(3.026)+(17.009), (I-655)+(3.026)+(17.010), (I-655)+(3.026)+(17.011), (I-655)+(3.026)+(17.012), (I-655)+(3.026)+(18.001),

(I-655)+(3.027)+(3.025), (I-655)+(3.027)+(3.030), (I-655)+(3.027)+(3.031), (I-655)+(3.027)+(5.001), (I-655)+(3.027)+(5.002), (I-655)+(3.027)+(5.003), (I-655)+(3.027)+(5.004), (I-655)+(3.027)+(5.005), (I-655)+(3.027)+(5.006), (I-655)+(3.027)+(5.007), (I-655)+(3.027)+(5.008), (I-655)+(3.027)+(5.009), (I-655)+(3.027)+(5.010), (I-655)+(3.027)+(5.011), (I-655)+(3.027)+(5.012), (I-655)+(3.027)+(5.013), (I-655)+(3.027)+(5.014), (I-655)+(3.027)+(5.015), (I-655)+(3.027)+(5.016), (I-655)+(3.027)+(5.017), (I-655)+(3.027)+(5.018), (I-655)+(3.027)+(5.019), (I-655)+(3.027)+(5.020), (I-655)+(3.027)+(5.021), (I-655)+(3.027)+(5.022), (I-655)+(3.027)+(5.023), (I-655)+(3.027)+(6.001), (I-655)+(3.027)+(6.002), (I-655)+(3.027)+(6.003), (I-655)+(3.027)+(6.004), (I-655)+(3.027)+(7.001), (I-655)+(3.027)+(7.002), (I-655)+(3.027)+(7.003), (I-655)+(3.027)+(7.004), (I-655)+(3.027)+(7.005), (I-655)+(3.027)+(7.006), (I-655)+(3.027)+(9.001), (I-655)+(3.027)+(9.002), (I-655)+(3.027)+(9.003), (I-655)+(3.027)+(9.004), (I-655)+(3.027)+(9.005), (I-655)+(3.027)+(9.006), (I-655)+(3.027)+(9.007), (I-655)+(3.027)+(9.008), (I-655)+(3.027)+(9.009), (I-655)+(3.027)+(14.001), (I-655)+(3.027)+(14.002), (I-655)+(3.027)+(15.008), (I-655)+(3.027)+(15.011), (I-655)+(3.027)+(15.012), (I-655)+(3.027)+(15.016), (I-655)+(3.027)+(15.025), (I-655)+(3.027)+(15.027), (I-655)+(3.027)+(15.047), (I-655)+(3.027)+(15.063), (I-655)+(3.027)+(15.064), (I-655)+(3.027)+(16.001), (I-655)+(3.027)+(16.002), (I-655)+(3.027)+(16.003), (I-655)+(3.027)+(16.004), (I-655)+(3.027)+(16.005), (I-655)+(3.027)+(16.006), (I-655)+(3.027)+(16.007), (I-655)+(3.027)+(16.008), (I-655)+(3.027)+(17.001), (I-655)+(3.027)+(17.002), (I-655)+(3.027)+(17.003), (I-655)+(3.027)+(17.004), (I-655)+(3.027)+(17.005), (I-655)+(3.027)+(17.006), (I-655)+(3.027)+(17.007), (I-655)+(3.027)+(17.008), (I-655)+(3.027)+(17.009), (I-655)+(3.027)+(17.010), (I-655)+(3.027)+(17.011), (I-655)+(3.027)+(17.012), (I-655)+(3.027)+(18.001),

(I-655)+(3.028)+(3.025), (I-655)+(3.028)+(3.030), (I-655)+(3.028)+(3.031), (I-655)+(3.028)+(5.001), (I-655)+(3.028)+(5.002), (I-655)+(3.028)+(5.003), (I-655)+(3.028)+(5.004), (I-655)+(3.028)+(5.005), (I-655)+(3.028)+(5.006), (I-655)+(3.028)+(5.007), (I-655)+(3.028)+(5.008), (I-655)+(3.028)+(5.009), (I-655)+(3.028)+(5.010), (I-655)+(3.028)+(5.011), (I-655)+(3.028)+(5.012), (I-655)+(3.028)+(5.013), (I-655)+(3.028)+(5.014), (I-655)+(3.028)+(5.015), (I-655)+(3.028)+(5.016), (I-655)+(3.028)+(5.017), (I-655)+(3.028)+(5.018), (I-655)+(3.028)+(5.019), (I-655)+(3.028)+(5.020), (I-655)+(3.028)+(5.021), (I-655)+(3.028)+(5.022), (I-655)+(3.028)+(5.023), (I-655)+(3.028)+(6.001), (I-655)+(3.028)+(6.002), (I-655)+(3.028)+(6.003), (I-655)+(3.028)+(6.004), (I-655)+(3.028)+(7.001), (I-655)+(3.028)+(7.002), (I-655)+(3.028)+(7.003), (I-655)+(3.028)+(7.004), (I-655)+(3.028)+(7.005), (I-655)+(3.028)+(7.006), (I-655)+(3.028)+(9.001), (I-655)+(3.028)+(9.002), (I-655)+(3.028)+(9.003), (I-655)+(3.028)+(9.004), (I-655)+(3.028)+(9.005), (I-655)+(3.028)+(9.006), (I-655)+(3.028)+(9.007), (I-655)+(3.028)+(9.008), (I-655)+(3.028)+(9.009), (I-655)+(3.028)+(14.001), (I-655)+(3.028)+(14.002), (I-655)+(3.028)+(15.008), (I-655)+(3.028)+(15.011), (I-655)+(3.028)+(15.012), (I-655)+(3.028)+(15.016), (I-655)+(3.028)+(15.025), (I-655)+(3.028)+(15.027), (I-655)+(3.028)+(15.047), (I-655)+(3.028)+(15.063), (I-655)+(3.028)+(15.064), (I-655)+(3.028)+(16.001), (I-655)+(3.028)+(16.002), (I-655)+(3.028)+(16.003), (I-655)+(3.028)+(16.004), (I-655)+(3.028)+(16.005), (I-655)+(3.028)+(16.006), (I-655)+(3.028)+(16.007), (I-655)+(3.028)+(16.008), (I-655)+(3.028)+(17.001), (I-655)+(3.028)+(17.002), (I-655)+(3.028)+(17.003), (I-655)+(3.028)+(17.004), (I-655)+(3.028)+(17.005), (I-655)+(3.028)+(17.006), (I-655)+(3.028)+(17.007), (I-655)+(3.028)+(17.008), (I-655)+(3.028)+(17.009), (I-655)+(3.028)+(17.010), (I-655)+(3.028)+(17.011), (I-655)+(3.028)+(17.012), (I-655)+(3.028)+(18.001),

(I-655)+(3.029)+(3.025), (I-655)+(3.029)+(3.030), (I-655)+(3.029)+(3.031), (I-655)+(3.029)+(5.001), (I-655)+(3.029)+(5.002), (I-655)+(3.029)+(5.003), (I-655)+(3.029)+(5.004), (I-655)+(3.029)+(5.005), (I-655)+(3.029)+(5.006), (I-655)+(3.029)+(5.007), (I-655)+(3.029)+(5.008), (I-655)+(3.029)+(5.009), (I-655)+(3.029)+(5.010), (I-655)+(3.029)+(5.011), (I-655)+(3.029)+(5.012), (I-655)+(3.029)+(5.013), (I-655)+(3.029)+(5.014), (I-655)+(3.029)+(5.015), (I-655)+(3.029)+(5.016), (I-655)+(3.029)+(5.017), (I-655)+(3.029)+(5.018), (I-655)+(3.029)+(5.019), (I-655)+(3.029)+(5.020), (I-655)+(3.029)+(5.021), (I-655)+(3.029)+(5.022), (I-655)+(3.029)+(5.023), (I-655)+(3.029)+(6.001), (I-655)+(3.029)+(6.002), (I-655)+(3.029)+(6.003), (I-655)+(3.029)+(6.004), (I-655)+(3.029)+(7.001), (I-655)+(3.029)+(7.002), (I-655)+(3.029)+(7.003), (I-655)+(3.029)+(7.004), (I-655)+(3.029)+(7.005), (I-655)+(3.029)+(7.006), (I-655)+(3.029)+(9.001), (I-655)+(3.029)+(9.002), (I-655)+(3.029)+(9.003), (I-655)+(3.029)+(9.004), (I-655)+(3.029)+(9.005), (I-655)+(3.029)+(9.006), (I-655)+(3.029)+(9.007), (I-655)+(3.029)+(9.008), (I-655)+(3.029)+(9.009), (I-655)+(3.029)+(14.001), (I-655)+(3.029)+(14.002), (I-655)+(3.029)+(15.008), (I-655)+(3.029)+(15.011), (I-655)+(3.029)+(15.012), (I-655)+(3.029)+(15.016), (I-655)+(3.029)+(15.025), (I-655)+(3.029)+(15.027), (I-655)+(3.029)+(15.047), (I-655)+(3.029)+(15.063), (I-655)+(3.029)+(15.064), (I-655)+(3.029)+(16.001), (I-655)+(3.029)+(16.002), (I-655)+(3.029)+(16.003), (I-655)+(3.029)+(16.004), (I-655)+(3.029)+(16.005), (I-655)+(3.029)+(16.006), (I-655)+(3.029)+(16.007), (I-655)+(3.029)+(16.008), (I-655)+(3.029)+(17.001), (I-655)+(3.029)+(17.002), (I-655)+(3.029)+(17.003), (I-655)+(3.029)+(17.004), (I-655)+(3.029)+(17.005), (I-655)+(3.029)+(17.006), (I-655)+(3.029)+(17.007), (I-655)+(3.029)+(17.008), (I-655)+(3.029)+(17.009), (I-655)+(3.029)+(17.010), (I-655)+(3.029)+(17.011), (I-655)+(3.029)+(17.012), (I-655)+(3.029)+(18.001),

(I-655)+(3.030)+(3.025), (I-655)+(3.030)+(3.031), (I-655)+(3.030)+(5.001), (I-655)+(3.030)+(5.002), (I-655)+(3.030)+(5.003), (I-655)+(3.030)+(5.004), (I-655)+(3.030)+(5.005), (I-655)+(3.030)+(5.006), (I-655)+(3.030)+(5.007), (I-655)+(3.030)+(5.008), (I-655)+(3.030)+(5.009), (I-655)+(3.030)+(5.010), (I-655)+(3.030)+(5.011), (I-655)+(3.030)+(5.012), (I-655)+(3.030)+(5.013), (I-655)+(3.030)+(5.014), (I-655)+(3.030)+(5.015), (I-655)+(3.030)+(5.016), (I-655)+(3.030)+(5.017), (I-655)+(3.030)+(5.018), (I-655)+(3.030)+(5.019), (I-655)+(3.030)+(5.020), (I-655)+(3.030)+(5.021), (I-655)+(3.030)+(5.022), (I-655)+(3.030)+(5.023), (I-655)+(3.030)+(6.001), (I-655)+(3.030)+(6.002), (I-655)+(3.030)+(6.003), (I-655)+(3.030)+(6.004), (I-655)+(3.030)+(7.001), (I-655)+(3.030)+(7.002), (I-655)+(3.030)+(7.003), (I-655)+(3.030)+(7.004), (I-655)+(3.030)+(7.005), (I-655)+(3.030)+(7.006), (I-655)+(3.030)+(9.001), (I-655)+(3.030)+(9.002), (I-655)+(3.030)+(9.003), (I-655)+(3.030)+(9.004), (I-655)+(3.030)+(9.005), (I-655)+(3.030)+(9.006), (I-655)+(3.030)+(9.007), (I-655)+(3.030)+(9.008), (I-655)+(3.030)+(9.009), (I-655)+(3.030)+(14.001), (I-655)+(3.030)+(14.002), (I-655)+(3.030)+(15.008), (I-655)+(3.030)+(15.011), (I-655)+(3.030)+(15.012), (I-655)+(3.030)+(15.016), (I-655)+(3.030)+(15.025), (I-655)+(3.030)+(15.027), (I-655)+(3.030)+(15.047), (I-655)+(3.030)+(15.063), (I-655)+(3.030)+(15.064), (I-655)+(3.030)+(16.001), (I-655)+(3.030)+(16.002), (I-655)+(3.030)+(16.003), (I-655)+(3.030)+(16.004), (I-655)+(3.030)+(16.005), (I-655)+(3.030)+(16.006), (I-655)+(3.030)+(16.007), (I-655)+(3.030)+(16.008), (I-655)+(3.030)+(17.001), (I-655)+(3.030)+(17.002), (I-655)+(3.030)+(17.003), (I-655)+(3.030)+(17.004), (I-655)+(3.030)+(17.005), (I-655)+(3.030)+(17.006), (I-655)+(3.030)+(17.007), (I-655)+(3.030)+(17.008), (I-655)+(3.030)+(17.009), (I-655)+(3.030)+(17.010), (I-655)+(3.030)+(17.011), (I-655)+(3.030)+(17.012), (I-655)+(3.030)+(18.001),

(I-655)+(3.031)+(3.025), (I-655)+(3.031)+(3.030), (I-655)+(3.031)+(5.001), (I-655)+(3.031)+(5.002), (I-655)+(3.031)+(5.003), (I-655)+(3.031)+(5.004), (I-655)+(3.031)+(5.005), (I-655)+(3.031)+(5.006), (I-655)+(3.031)+(5.007), (I-655)+(3.031)+(5.008), (I-655)+(3.031)+(5.009), (I-655)+(3.031)+(5.010), (I-655)+(3.031)+(5.011), (I-655)+(3.031)+(5.012), (I-655)+(3.031)+(5.013), (I-655)+(3.031)+(5.014), (I-655)+(3.031)+(5.015), (I-655)+(3.031)+(5.016), (I-655)+(3.031)+(5.017), (I-655)+(3.031)+(5.018), (I-655)+(3.031)+(5.019), (I-655)+(3.031)+(5.020), (I-655)+(3.031)+(5.021), (I-655)+(3.031)+(5.022), (I-655)+(3.031)+(5.023), (I-655)+(3.031)+(6.001), (I-655)+(3.031)+(6.002), (I-655)+(3.031)+(6.003), (I-655)+(3.031)+(6.004), (I-655)+(3.031)+(7.001), (I-655)+(3.031)+(7.002), (I-655)+(3.031)+(7.003), (I-655)+(3.031)+(7.004), (I-655)+(3.031)+(7.005), (I-655)+(3.031)+(7.006), (I-655)+(3.031)+(9.001), (I-655)+(3.031)+(9.002), (I-655)+(3.031)+(9.003), (I-655)+(3.031)+(9.004), (I-655)+(3.031)+(9.005), (I-655)+(3.031)+(9.006), (I-655)+(3.031)+(9.007), (I-655)+(3.031)+(9.008), (I-655)+(3.031)+(9.009), (I-655)+(3.031)+(14.001), (I-655)+(3.031)+(14.002), (I-655)+(3.031)+(15.008), (I-655)+(3.031)+(15.011), (I-655)+(3.031)+(15.012), (I-655)+(3.031)+(15.016), (I-655)+(3.031)+(15.025), (I-655)+(3.031)+(15.027), (I-655)+(3.031)+(15.047), (I-655)+(3.031)+(15.063), (I-655)+(3.031)+(15.064), (I-655)+(3.031)+(16.001), (I-655)+(3.031)+(16.002), (I-655)+(3.031)+(16.003), (I-655)+(3.031)+(16.004), (I-655)+(3.031)+(16.005), (I-655)+(3.031)+(16.006), (I-655)+(3.031)+(16.007), (I-655)+(3.031)+(16.008), (I-655)+(3.031)+(17.001), (I-655)+(3.031)+(17.002), (I-655)+(3.031)+(17.003), (I-655)+(3.031)+(17.004), (I-655)+(3.031)+(17.005), (I-655)+(3.031)+(17.006), (I-655)+(3.031)+(17.007), (I-655)+(3.031)+(17.008), (I-655)+(3.031)+(17.009), (I-655)+(3.031)+(17.010), (I-655)+(3.031)+(17.011), (I-655)+(3.031)+(17.012), (I-655)+(3.031)+(18.001), (I-655)+(5.001)+(9.001), (I-655)+(5.001)+(9.002), (I-655)+(5.001)+(9.003), (I-655)+(5.001)+(9.004), (I-655)+(5.001)+(9.005), (I-655)+(5.001)+(9.006), (I-655)+(5.001)+(9.007), (I-655)+(5.001)+(9.008), (I-655)+(5.001)+(9.009), (I-655)+(5.001)+(15.012), (I-655)+(5.001)+(15.016), (I-655)+(5.001)+(15.025), (I-655)+(5.001)+(15.027), (I-655)+(5.001)+(15.047), (I-655)+(5.001)+(15.063), (I-655)+(5.001)+(15.064),

(I-655)+(5.002)+(9.001), (I-655)+(5.002)+(9.002), (I-655)+(5.002)+(9.003), (I-655)+(5.002)+(9.004), (I-655)+(5.002)+(9.005), (I-655)+(5.002)+(9.006), (I-655)+(5.002)+(9.007), (I-655)+(5.002)+(9.008), (I-655)+(5.002)+(9.009), (I-655)+(5.002)+(15.012), (I-655)+(5.002)+(15.016), (I-655)+(5.002)+(15.025), (I-655)+(5.002)+(15.027), (I-655)+(5.002)+(15.047), (I-655)+(5.002)+(15.063), (I-655)+(5.002)+(15.064),

(I-655)+(5.003)+(9.001), (I-655)+(5.003)+(9.002), (I-655)+(5.003)+(9.003), (I-655)+(5.003)+(9.004), (I-655)+(5.003)+(9.005), (I-655)+(5.003)+(9.006), (I-655)+(5.003)+(9.007), (I-655)+(5.003)+(9.008), (I-655)+(5.003)+(9.009), (I-655)+(5.003)+(15.012), (I-655)+(5.003)+(15.016), (I-655)+(5.003)+(15.025), (I-655)+(5.003)+(15.027), (I-655)+(5.003)+(15.047), (I-655)+(5.003)+(15.063), (I-655)+(5.003)+(15.064),

(I-655)+(5.004)+(9.001), (I-655)+(5.004)+(9.002), (I-655)+(5.004)+(9.003), (I-655)+(5.004)+(9.004), (I-655)+(5.004)+(9.005), (I-655)+(5.004)+(9.006), (I-655)+(5.004)+(9.007), (I-655)+(5.004)+(9.008), (I-655)+(5.004)+(9.009), (I-655)+(5.004)+(15.012), (I-655)+(5.004)+(15.016), (I-655)+(5.004)+(15.025), (I-655)+(5.004)+(15.027), (I-655)+(5.004)+(15.047), (I-655)+(5.004)+(15.063), (I-655)+(5.004)+(15.064),

(I-655)+(5.005)+(9.001), (I-655)+(5.005)+(9.002), (I-655)+(5.005)+(9.003), (I-655)+(5.005)+(9.004), (I-655)+(5.005)+(9.005), (I-655)+(5.005)+(9.006), (I-655)+(5.005)+(9.007), (I-655)+(5.005)+(9.008), (I-655)+(5.005)+(9.009), (I-655)+(5.005)+(15.012), (I-655)+(5.005)+(15.016), (I-655)+(5.005)+(15.025), (I-655)+(5.005)+(15.027), (I-655)+(5.005)+(15.047), (I-655)+(5.005)+(15.063), (I-655)+(5.005)+(15.064),

(I-655)+(5.006)+(9.001), (I-655)+(5.006)+(9.002), (I-655)+(5.006)+(9.003), (I-655)+(5.006)+(9.004), (I-655)+(5.006)+(9.005), (I-655)+(5.006)+(9.006), (I-655)+(5.006)+(9.007), (I-655)+(5.006)+(9.008), (I-655)+(5.006)+(9.009), (I-655)+(5.006)+(15.012), (I-655)+(5.006)+(15.016), (I-655)+(5.006)+(15.025), (I-655)+(5.006)+(15.027), (I-655)+(5.006)+(15.047), (I-655)+(5.006)+(15.063), (I-655)+(5.006)+(15.064),

(I-655)+(5.007)+(9.001), (I-655)+(5.007)+(9.002), (I-655)+(5.007)+(9.003), (I-655)+(5.007)+(9.004), (I-655)+(5.007)+(9.005), (I-655)+(5.007)+(9.006), (I-655)+(5.007)+(9.007), (I-655)+(5.007)+(9.008), (I-655)+(5.007)+(9.009), (I-655)+(5.007)+(15.012), (I-655)+(5.007)+(15.016), (I-655)+(5.007)+(15.025), (I-655)+(5.007)+(15.027), (I-655)+(5.007)+(15.047), (I-655)+(5.007)+(15.063), (I-655)+(5.007)+(15.064),

(I-655)+(5.008)+(9.001), (I-655)+(5.008)+(9.002), (I-655)+(5.008)+(9.003), (I-655)+(5.008)+(9.004), (I-655)+(5.008)+(9.005), (I-655)+(5.008)+(9.006), (I-655)+(5.008)+(9.007), (I-655)+(5.008)+(9.008), (I-655)+(5.008)+(9.009), (I-655)+(5.008)+(15.012), (I-655)+(5.008)+(15.016), (I-655)+(5.008)+(15.025), (I-655)+(5.008)+(15.027), (I-655)+(5.008)+(15.047), (I-655)+(5.008)+(15.063), (I-655)+(5.008)+(15.064),

(I-655)+(5.009)+(9.001), (I-655)+(5.009)+(9.002), (I-655)+(5.009)+(9.003), (I-655)+(5.009)+(9.004), (I-655)+(5.009)+(9.005), (I-655)+(5.009)+(9.006), (I-655)+(5.009)+(9.007), (I-655)+(5.009)+(9.008), (I-655)+(5.009)+(9.009), (I-655)+(5.009)+(15.012), (I-655)+(5.009)+(15.016), (I-655)+(5.009)+(15.025), (I-655)+(5.009)+(15.027), (I-655)+(5.009)+(15.047), (I-655)+(5.009)+(15.063), (I-655)+(5.009)+(15.064),

(I-655)+(5.010)+(9.001), (I-655)+(5.010)+(9.002), (I-655)+(5.010)+(9.003), (I-655)+(5.010)+(9.004), (I-655)+(5.010)+(9.005), (I-655)+(5.010)+(9.006), (I-655)+(5.010)+(9.007), (I-655)+(5.010)+(9.008), (I-655)+(5.010)+(9.009), (I-655)+(5.010)+(15.012), (I-655)+(5.010)+(15.016), (I-655)+(5.010)+(15.025), (I-655)+(5.010)+(15.027), (I-655)+(5.010)+(15.047), (I-655)+(5.010)+(15.063), (I-655)+(5.010)+(15.064),

(I-655)+(5.011)+(9.001), (I-655)+(5.011)+(9.002), (I-655)+(5.011)+(9.003), (I-655)+(5.011)+(9.004), (I-655)+(5.011)+(9.005), (I-655)+(5.011)+(9.006), (I-655)+(5.011)+(9.007), (I-655)+(5.011)+(9.008), (I-655)+(5.011)+(9.009), (I-655)+(5.011)+(15.012), (I-655)+(5.011)+(15.016), (I-655)+(5.011)+(15.025), (I-655)+(5.011)+(15.027), (I-655)+(5.011)+(15.047), (I-655)+(5.011)+(15.063), (I-655)+(5.011)+(15.064),

(I-655)+(5.012)+(9.001), (I-655)+(5.012)+(9.002), (I-655)+(5.012)+(9.003), (I-655)+(5.012)+(9.004), (I-655)+(5.012)+(9.005), (I-655)+(5.012)+(9.006), (I-655)+(5.012)+(9.007), (I-655)+(5.012)+(9.008), (I-655)+(5.012)+(9.009), (I-655)+(5.012)+(15.012), (I-655)+(5.012)+(15.016), (I-655)+(5.012)+(15.025), (I-655)+(5.012)+(15.027), (I-655)+(5.012)+(15.047), (I-655)+(5.012)+(15.063), (I-655)+(5.012)+(15.064),

(I-655)+(5.013)+(9.001), (I-655)+(5.013)+(9.002), (I-655)+(5.013)+(9.003), (I-655)+(5.013)+(9.004), (I-655)+(5.013)+(9.005), (I-655)+(5.013)+(9.006), (I-655)+(5.013)+(9.007), (I-655)+(5.013)+(9.008), (I-655)+(5.013)+(9.009), (I-655)+(5.013)+(15.012), (I-655)+(5.013)+(15.016), (I-655)+(5.013)+(15.025), (I-655)+(5.013)+(15.027), (I-655)+(5.013)+(15.047), (I-655)+(5.013)+(15.063), (I-655)+(5.013)+(15.064),

(I-655)+(5.014)+(9.001), (I-655)+(5.014)+(9.002), (I-655)+(5.014)+(9.003), (I-655)+(5.014)+(9.004), (I-655)+(5.014)+(9.005), (I-655)+(5.014)+(9.006), (I-655)+(5.014)+(9.007), (I-655)+(5.014)+(9.008), (I-655)+(5.014)+(9.009), (I-655)+(5.014)+(15.012), (I-655)+(5.014)+(15.016), (I-655)+(5.014)+(15.025), (I-655)+(5.014)+(15.027), (I-655)+(5.014)+(15.047), (I-655)+(5.014)+(15.063), (I-655)+(5.014)+(15.064),

(I-655)+(5.015)+(9.001), (I-655)+(5.015)+(9.002), (I-655)+(5.015)+(9.003), (I-655)+(5.015)+(9.004), (I-655)+(5.015)+(9.005), (I-655)+(5.015)+(9.006), (I-655)+(5.015)+(9.007), (I-655)+(5.015)+(9.008), (I-655)+(5.015)+(9.009), (I-655)+(5.015)+(15.012), (I-655)+(5.015)+(15.016), (I-655)+(5.015)+(15.025), (I-655)+(5.015)+(15.027), (I-655)+(5.015)+(15.047), (I-655)+(5.015)+(15.063), (I-655)+(5.015)+(15.064),

(I-655)+(5.016)+(9.001), (I-655)+(5.016)+(9.002), (I-655)+(5.016)+(9.003), (I-655)+(5.016)+(9.004), (I-655)+(5.016)+(9.005), (I-655)+(5.016)+(9.006), (I-655)+(5.016)+(9.007), (I-655)+(5.016)+(9.008), (I-655)+(5.016)+(9.009), (I-655)+(5.016)+(15.012), (I-655)+(5.016)+(15.016), (I-655)+(5.016)+(15.025), (I-655)+(5.016)+(15.027), (I-655)+(5.016)+(15.047), (I-655)+(5.016)+(15.063), (I-655)+(5.016)+(15.064),

(I-655)+(5.017)+(9.001), (I-655)+(5.017)+(9.002), (I-655)+(5.017)+(9.003), (I-655)+(5.017)+(9.004), (I-655)+(5.017)+(9.005), (I-655)+(5.017)+(9.006), (I-655)+(5.017)+(9.007), (I-655)+(5.017)+(9.008), (I-655)+(5.017)+(9.009), (I-655)+(5.017)+(15.012), (I-655)+(5.017)+(15.016), (I-655)+(5.017)+(15.025), (I-655)+(5.017)+(15.027), (I-655)+(5.017)+(15.047), (I-655)+(5.017)+(15.063), (I-655)+(5.017)+(15.064),

(I-655)+(5.018)+(9.001), (I-655)+(5.018)+(9.002), (I-655)+(5.018)+(9.003), (I-655)+(5.018)+(9.004), (I-655)+(5.018)+(9.005), (I-655)+(5.018)+(9.006), (I-655)+(5.018)+(9.007), (I-655)+(5.018)+(9.008), (I-655)+(5.018)+(9.009), (I-655)+(5.018)+(15.012), (I-655)+(5.018)+(15.016), (I-655)+(5.018)+(15.025), (I-655)+(5.018)+(15.027), (I-655)+(5.018)+(15.047), (I-655)+(5.018)+(15.063), (I-655)+(5.018)+(15.064),

(I-655)+(5.019)+(9.001), (I-655)+(5.019)+(9.002), (I-655)+(5.019)+(9.003), (I-655)+(5.019)+(9.004), (I-655)+(5.019)+(9.005), (I-655)+(5.019)+(9.006), (I-655)+(5.019)+(9.007), (I-655)+(5.019)+(9.008), (I-655)+(5.019)+(9.009), (I-655)+(5.019)+(15.012), (I-655)+(5.019)+(15.016), (I-655)+(5.019)+(15.025), (I-655)+(5.019)+(15.027), (I-655)+(5.019)+(15.047), (I-655)+(5.019)+(15.063), (I-655)+(5.019)+(15.064),

(I-655)+(5.020)+(9.001), (I-655)+(5.020)+(9.002), (I-655)+(5.020)+(9.003), (I-655)+(5.020)+(9.004), (I-655)+(5.020)+(9.005), (I-655)+(5.020)+(9.006), (I-655)+(5.020)+(9.007), (I-655)+(5.020)+(9.008), (I-655)+(5.020)+(9.009), (I-655)+(5.020)+(15.012), (I-655)+(5.020)+(15.016), (I-655)+(5.020)+(15.025), (I-655)+(5.020)+(15.027), (I-655)+(5.020)+(15.047), (I-655)+(5.020)+(15.063), (I-655)+(5.020)+(15.064),

(I-655)+(5.021)+(9.001), (I-655)+(5.021)+(9.002), (I-655)+(5.021)+(9.003), (I-655)+(5.021)+(9.004), (I-655)+(5.021)+(9.005), (I-655)+(5.021)+(9.006), (I-655)+(5.021)+(9.007), (I-655)+(5.021)+(9.008), (I-655)+(5.021)+(9.009), (I-655)+(5.021)+(15.012), (I-655)+(5.021)+(15.016), (I-655)+(5.021)+(15.025), (I-655)+(5.021)+(15.027), (I-655)+(5.021)+(15.047), (I-655)+(5.021)+(15.063), (I-655)+(5.021)+(15.064),

(I-655)+(5.022)+(9.001), (I-655)+(5.022)+(9.002), (I-655)+(5.022)+(9.003), (I-655)+(5.022)+(9.004), (I-655)+(5.022)+(9.005), (I-655)+(5.022)+(9.006), (I-655)+(5.022)+(9.007), (I-655)+(5.022)+(9.008), (I-655)+(5.022)+(9.009), (I-655)+(5.022)+(15.012), (I-655)+(5.022)+(15.016), (I-655)+(5.022)+(15.025), (I-655)+(5.022)+(15.027), (I-655)+(5.022)+(15.047), (I-655)+(5.022)+(15.063), (I-655)+(5.022)+(15.064),

(I-655)+(5.023)+(9.001), (I-655)+(5.023)+(9.002), (I-655)+(5.023)+(9.003), (I-655)+(5.023)+(9.004), (I-655)+(5.023)+(9.005), (I-655)+(5.023)+(9.006), (I-655)+(5.023)+(9.007), (I-655)+(5.023)+(9.008), (I-655)+(5.023)+(9.009), (I-655)+(5.023)+(15.012), (I-655)+(5.023)+(15.016), (I-655)+(5.023)+(15.025), (I-655)+(5.023)+(15.027), (I-655)+(5.023)+(15.047), (I-655)+(5.023)+(15.063), (I-655)+(5.023)+(15.064).

If two compounds (B) are present in the combinations according to the invention, preferred compound combinations are also selected from the group (G3-C) consisting of the following mixtures:

(I-746)+(1.001)+(1.002), (I-746)+(1.001)+(1.003), (I-746)+(1.001)+(1.004), (I-746)+(1.001)+(1.005), (I-746)+(1.001)+(1.006), (I-746)+(1.001)+(1.007), (I-746)+(1.001)+(1.008), (I-746)+(1.001)+(1.009), (I-746)+(1.001)+(1.010), (I-746)+(1.001)+(1.011), (I-746)+(1.001)+(1.012), (I-746)+(1.001)+(1.013), (I-746)+(1.001)+(1.014), (I-746)+(1.001)+(1.015), (I-746)+(1.001)+(1.016), (I-746)+(1.001)+(1.017), (I-746)+(1.001)+(1.018), (I-746)+(1.001)+(1.019), (I-746)+(1.001)+(1.020), (I-746)+(1.001)+(1.021), (I-746)+(1.001)+(1.022), (I-746)+(1.001)+(1.023), (I-746)+(1.001)+(1.024), (I-746)+(1.001)+(1.025), (I-746)+(1.001)+(1.026), (I-746)+(1.001)+(1.027), (I-746)+(1.001)+(1.028), (I-746)+(1.001)+(1.029), (I-746)+(1.001)+(1.030), (I-746)+(1.001)+(1.031), (I-746)+(1.001)+(1.032), (I-746)+(1.001)+(1.033), (I-746)+(1.001)+(1.034), (I-746)+(1.001)+(1.035), (I-746)+(1.001)+(1.036), (I-746)+(1.001)+(1.037), (I-746)+(1.001)+(1.038), (I-746)+(1.001)+(1.039), (I-746)+(1.001)+(1.040), (I-746)+(1.001)+(1.041), (I-746)+(1.001)+(1.042), (I-746)+(1.001)+(1.043), (I-746)+(1.001)+(1.044), (I-746)+(1.001)+(1.045), (I-746)+(1.001)+(1.046), (I-746)+(1.001)+(1.047), (I-746)+(1.001)+(1.048), (I-746)+(1.001)+(1.049), (I-746)+(1.001)+(1.050), (I-746)+(1.001)+(1.051), (I-746)+(1.001)+(1.052), (I-746)+(1.001)+(1.053), (I-746)+(1.001)+(1.054), (I-746)+(1.001)+(1.055), (I-746)+(1.001)+(1.056), (I-746)+(1.001)+(1.057), (I-746)+(1.001)+(1.058), (I-746)+(1.001)+(1.059), (I-746)+(1.001)+(1.060), (I-746)+(1.001)+(1.061), (I-746)+(1.001)+(1.062), (I-746)+(1.001)+(1.063), (I-746)+(1.001)+(1.064), (I-746)+(1.001)+(1.065), (I-746)+(1.001)+(1.066), (I-746)+(1.001)+(1.067), (I-746)+(1.001)+(1.068), (I-746)+(1.001)+(1.069), (I-746)+(1.001)+(1.070), (I-746)+(1.001)+(1.071), (I-746)+(1.001)+(1.072), (I-746)+(1.001)+(1.073), (I-746)+(1.001)+(1.074), (I-746)+(1.001)+(1.075), (I-746)+(1.001)+(1.076), (I-746)+(1.001)+(1.077), (I-746)+(1.001)+(1.078), (I-746)+(1.001)+(1.079), (I-746)+(1.001)+(1.080), (I-746)+(1.001)+(1.081), (I-746)+(1.001)+(1.082), (I-746)+(1.001)+(1.083), (I-746)+(1.001)+(1.084), (I-746)+(1.001)+(1.085), (I-746)+(1.001)+(1.086), (I-746)+(1.001)+(1.087), (I-746)+(1.001)+(1.088), (I-746)+(1.001)+(1.089), (I-746)+(1.001)+(1.090), (I-746)+(1.001)+(1.091), (I-746)+(1.001)+(1.092), (I-746)+(1.001)+(2.001), (I-746)+(1.001)+(2.002), (I-746)+(1.001)+(2.003), (I-746)+(1.001)+(2.004), (I-746)+(1.001)+(2.005), (I-746)+(1.001)+(2.006), (I-746)+(1.001)+(2.007), (I-746)+(1.001)+(2.008), (I-746)+(1.001)+(2.009), (I-746)+(1.001)+(2.010), (I-746)+(1.001)+(2.011), (I-746)+(1.001)+(2.012), (I-746)+(1.001)+(2.013), (I-746)+(1.001)+(2.014), (I-746)+(1.001)+(2.015), (I-746)+(1.001)+(2.016), (I-746)+(1.001)+(2.017), (I-746)+(1.001)+(2.018), (I-746)+(1.001)+(2.019), (I-746)+(1.001)+(2.020), (I-746)+(1.001)+(2.021), (I-746)+(1.001)+(2.022), (I-746)+(1.001)+(2.023), (I-746)+(1.001)+(2.024), (I-746)+(1.001)+(2.025), (I-746)+(1.001)+(2.026), (I-746)+(1.001)+(2.027), (I-746)+(1.001)+(2.028), (I-746)+(1.001)+(2.029), (I-746)+(1.001)+(2.030), (I-746)+(1.001)+(2.031), (I-746)+(1.001)+(2.032), (I-746)+(1.001)+(2.033), (I-746)+(1.001)+(2.034), (I-746)+(1.001)+(2.035), (I-746)+(1.001)+(2.036), (I-746)+(1.001)+(2.037), (I-746)+(1.001)+(2.038), (I-746)+(1.001)+(2.039), (I-746)+(1.001)+(2.040), (I-746)+(1.001)+(2.041), (I-746)+(1.001)+(2.042), (I-746)+(1.001)+(2.043), (I-746)+(1.001)+(2.044), (I-746)+(1.001)+(2.045), (I-746)+(1.001)+(2.046), (I-746)+(1.001)+(2.047), (I-746)+(1.001)+(2.048), (I-746)+(1.001)+(2.049), (I-746)+(1.001)+(2.050), (I-746)+(1.001)+(2.051), (I-746)+(1.001)+(2.052), (I-746)+(1.001)+(2.053), (I-746)+(1.001)+(2.054), (I-746)+(1.001)+(2.055), (I-746)+(1.001)+(2.056), (I-746)+(1.001)+(2.057), (I-746)+(1.001)+(2.058), (I-746)+(1.001)+(2.059), (I-746)+(1.001)+(3.001), (I-746)+(1.001)+(3.002), (I-746)+(1.001)+(3.003), (I-746)+(1.001)+(3.004), (I-746)+(1.001)+(3.005), (I-746)+(1.001)+(3.006), (I-746)+(1.001)+(3.007), (I-746)+(1.001)+(3.008), (I-746)+(1.001)+(3.009), (I-746)+(1.001)+(3.010), (I-746)+(1.001)+(3.011), (I-746)+(1.001)+(3.012), (I-746)+(1.001)+(3.013), (I-746)+(1.001)+(3.014), (I-746)+(1.001)+(3.015), (I-746)+(1.001)+(3.016), (I-746)+(1.001)+(3.017), (I-746)+(1.001)+(3.018), (I-746)+(1.001)+(3.019), (I-746)+(1.001)+(3.020), (I-746)+(1.001)+(3.021), (I-746)+(1.001)+(3.022), (I-746)+(1.001)+(3.023), (I-746)+(1.001)+(3.024), (I-746)+(1.001)+(3.025), (I-746)+(1.001)+(3.026), (I-746)+(1.001)+(3.027), (I-746)+(1.001)+(3.028), (I-746)+(1.001)+(3.029), (I-746)+(1.001)+(3.030), (I-746)+(1.001)+(3.031), (I-746)+(1.001)+(5.001), (I-746)+(1.001)+(5.002), (I-746)+(1.001)+(5.003), (I-746)+(1.001)+(5.004), (I-746)+(1.001)+(5.005), (I-746)+(1.001)+(5.006), (I-746)+(1.001)+(5.007), (I-746)+(1.001)+(5.008), (I-746)+(1.001)+(5.009), (I-746)+(1.001)+(5.010), (I-746)+(1.001)+(5.011), (I-746)+(1.001)+(5.012), (I-746)+(1.001)+(5.013), (I-746)+(1.001)+(5.014), (I-746)+(1.001)+(5.015), (I-746)+(1.001)+(5.016), (I-746)+(1.001)+(5.017), (I-746)+(1.001)+(5.018), (I-746)+(1.001)+(5.019), (I-746)+(1.001)+(5.020), (I-746)+(1.001)+(5.021), (I-746)+(1.001)+(5.022), (I-746)+(1.001)+(5.023), (I-746)+(1.001)+(6.001), (I-746)+(1.001)+(6.002), (I-746)+(1.001)+(6.003), (I-746)+(1.001)+(6.004), (I-746)+(1.001)+(7.001), (I-746)+(1.001)+(7.002), (I-746)+(1.001)+(7.003), (I-746)+(1.001)+(7.004), (I-746)+(1.001)+(7.005), (I-746)+(1.001)+(7.006), (I-746)+(1.001)+(9.001), (I-746)+(1.001)+(9.002), (I-746)+(1.001)+(9.003), (I-746)+(1.001)+(9.004), (I-746)+(1.001)+(9.005), (I-746)+(1.001)+(9.006), (I-746)+(1.001)+(9.007), (I-746)+(1.001)+(9.008), (I-746)+(1.001)+(9.009), (I-746)+(1.001)+(14.001), (I-746)+(1.001)+(14.002), (I-746)+(1.001)+(15.008), (I-746)+(1.001)+(15.011), (I-746)+(1.001)+(15.012), (I-746)+(1.001)+(15.016), (I-746)+(1.001)+(15.025), (I-746)+(1.001)+(15.027), (I-746)+(1.001)+(15.047), (I-746)+(1.001)+(15.063), (I-746)+(1.001)+(15.064), (I-746)+(1.001)+(16.001), (I-746)+(1.001)+(16.002), (I-746)+(1.001)+(16.003), (I-746)+(1.001)+(16.004), (I-746)+(1.001)+(16.005), (I-746)+(1.001)+(16.006), (I-746)+(1.001)+(16.007), (I-746)+(1.001)+(16.008), (I-746)+(1.001)+(17.001), (I-746)+(1.001)+(17.002), (I-746)+(1.001)+(17.003), (I-746)+(1.001)+(17.004), (I-746)+(1.001)+(17.005), (I-746)+(1.001)+(17.006), (I-746)+(1.001)+(17.007), (I-746)+(1.001)+(17.008), (I-746)+(1.001)+(17.009), (I-746)+(1.001)+(17.010), (I-746)+(1.001)+(17.011), (I-746)+(1.001)+(17.012), (I-746)+(1.001)+(18.001),

(I-746)+(1.002)+(1.003), (I-746)+(1.002)+(1.004), (I-746)+(1.002)+(1.005), (I-746)+(1.002)+(1.006), (I-746)+(1.002)+(1.007), (I-746)+(1.002)+(1.008), (I-746)+(1.002)+(1.009), (I-746)+(1.002)+(1.010), (I-746)+(1.002)+(1.011), (I-746)+(1.002)+(1.012), (I-746)+(1.002)+(1.013), (I-746)+(1.002)+(1.014), (I-746)+(1.002)+(1.015), (I-746)+(1.002)+(1.016), (I-746)+(1.002)+(1.017), (I-746)+(1.002)+(1.018), (I-746)+(1.002)+(1.019), (I-746)+(1.002)+(1.020), (I-746)+(1.002)+(1.021), (I-746)+(1.002)+(1.022), (I-746)+(1.002)+(1.023), (I-746)+(1.002)+(1.024), (I-746)+(1.002)+(1.025), (I-746)+(1.002)+(1.026), (I-746)+(1.002)+(1.027), (I-746)+(1.002)+(1.028), (I-746)+(1.002)+(1.029), (I-746)+(1.002)+(1.030), (I-746)+(1.002)+(1.031), (I-746)+(1.002)+(1.032), (I-746)+(1.002)+(1.033), (I-746)+(1.002)+(1.034), (I-746)+(1.002)+(1.035), (I-746)+(1.002)+(1.036), (I-746)+(1.002)+(1.037), (I-746)+(1.002)+(1.038), (I-746)+(1.002)+(1.039), (I-746)+(1.002)+(1.040), (I-746)+(1.002)+(1.041), (I-746)+(1.002)+(1.042), (I-746)+(1.002)+(1.043), (I-746)+(1.002)+(1.044), (I-746)+(1.002)+(1.045), (I-746)+(1.002)+(1.046), (I-746)+(1.002)+(1.047), (I-746)+(1.002)+(1.048), (I-746)+(1.002)+(1.049), (I-746)+(1.002)+(1.050), (I-746)+(1.002)+(1.051), (I-746)+(1.002)+(1.052), (I-746)+(1.002)+(1.053), (I-746)+(1.002)+(1.054), (I-746)+(1.002)+(1.055), (I-746)+(1.002)+(1.056), (I-746)+(1.002)+(1.057), (I-746)+(1.002)+(1.058), (I-746)+(1.002)+(1.059), (I-746)+(1.002)+(1.060), (I-746)+(1.002)+(1.061), (I-746)+(1.002)+(1.062), (I-746)+(1.002)+(1.063), (I-746)+(1.002)+(1.064), (I-746)+(1.002)+(1.065), (I-746)+(1.002)+(1.066), (I-746)+(1.002)+(1.067), (I-746)+(1.002)+(1.068), (I-746)+(1.002)+(1.069), (I-746)+(1.002)+(1.070), (I-746)+(1.002)+(1.071), (I-746)+(1.002)+(1.072), (I-746)+(1.002)+(1.073), (I-746)+(1.002)+(1.074), (I-746)+(1.002)+(1.075), (I-746)+(1.002)+(1.076), (I-746)+(1.002)+(1.077), (I-746)+(1.002)+(1.078), (I-746)+(1.002)+(1.079), (I-746)+(1.002)+(1.080), (I-746)+(1.002)+(1.081), (I-746)+(1.002)+(1.082), (I-746)+(1.002)+(1.083), (I-746)+(1.002)+(1.084), (I-746)+(1.002)+(1.085), (I-746)+(1.002)+(1.086), (I-746)+(1.002)+(1.087), (I-746)+(1.002)+(1.088), (I-746)+(1.002)+(1.089), (I-746)+(1.002)+(1.090), (I-746)+(1.002)+(1.091), (I-746)+(1.002)+(1.092), (I-746)+(1.002)+(2.001), (I-746)+(1.002)+(2.002), (I-746)+(1.002)+(2.003), (I-746)+(1.002)+(2.004), (I-746)+(1.002)+(2.005), (I-746)+(1.002)+(2.006), (I-746)+(1.002)+(2.007), (I-746)+(1.002)+(2.008), (I-746)+(1.002)+(2.009), (I-746)+(1.002)+(2.010), (I-746)+(1.002)+(2.011), (I-746)+(1.002)+(2.012), (I-746)+(1.002)+(2.013), (I-746)+(1.002)+(2.014), (I-746)+(1.002)+(2.015), (I-746)+(1.002)+(2.016), (I-746)+(1.002)+(2.017), (I-746)+(1.002)+(2.018), (I-746)+(1.002)+(2.019), (I-746)+(1.002)+(2.020), (I-746)+(1.002)+(2.021), (I-746)+(1.002)+(2.022), (I-746)+(1.002)+(2.023), (I-746)+(1.002)+(2.024), (I-746)+(1.002)+(2.025), (I-746)+(1.002)+(2.026), (I-746)+(1.002)+(2.027), (I-746)+(1.002)+(2.028), (I-746)+(1.002)+(2.029), (I-746)+(1.002)+(2.030), (I-746)+(1.002)+(2.031), (I-746)+(1.002)+(2.032), (I-746)+(1.002)+(2.033), (I-746)+(1.002)+(2.034), (I-746)+(1.002)+(2.035), (I-746)+(1.002)+(2.036), (I-746)+(1.002)+(2.037), (I-746)+(1.002)+(2.038), (I-746)+(1.002)+(2.039), (I-746)+(1.002)+(2.040), (I-746)+(1.002)+(2.041), (I-746)+(1.002)+(2.042), (I-746)+(1.002)+(2.043), (I-746)+(1.002)+(2.044), (I-746)+(1.002)+(2.045), (I-746)+(1.002)+(2.046), (I-746)+(1.002)+(2.047), (I-746)+(1.002)+(2.048), (I-746)+(1.002)+(2.049), (I-746)+(1.002)+(2.050), (I-746)+(1.002)+(2.051), (I-746)+(1.002)+(2.052), (I-746)+(1.002)+(2.053), (I-746)+(1.002)+(2.054), (I-746)+(1.002)+(2.055), (I-746)+(1.002)+(2.056), (I-746)+(1.002)+(2.057), (I-746)+(1.002)+(2.058), (I-746)+(1.002)+(2.059), (I-746)+(1.002)+(3.001), (I-746)+(1.002)+(3.002), (I-746)+(1.002)+(3.003), (I-746)+(1.002)+(3.004), (I-746)+(1.002)+(3.005), (I-746)+(1.002)+(3.006), (I-746)+(1.002)+(3.007), (I-746)+(1.002)+(3.008), (I-746)+(1.002)+(3.009), (I-746)+(1.002)+(3.010), (I-746)+(1.002)+(3.011), (I-746)+(1.002)+(3.012), (I-746)+(1.002)+(3.013), (I-746)+(1.002)+(3.014), (I-746)+(1.002)+(3.015), (I-746)+(1.002)+(3.016), (I-746)+(1.002)+(3.017), (I-746)+(1.002)+(3.018), (I-746)+(1.002)+(3.019), (I-746)+(1.002)+(3.020), (I-746)+(1.002)+(3.021), (I-746)+(1.002)+(3.022), (I-746)+(1.002)+(3.023), (I-746)+(1.002)+(3.024), (I-746)+(1.002)+(3.025), (I-746)+(1.002)+(3.026), (I-746)+(1.002)+(3.027), (I-746)+(1.002)+(3.028), (I-746)+(1.002)+(3.029), (I-746)+(1.002)+(3.030), (I-746)+(1.002)+(3.031), (I-746)+(1.002)+(5.001), (I-746)+(1.002)+(5.002), (I-746)+(1.002)+(5.003), (I-746)+(1.002)+(5.004), (I-746)+(1.002)+(5.005), (I-746)+(1.002)+(5.006), (I-746)+(1.002)+(5.007), (I-746)+(1.002)+(5.008), (I-746)+(1.002)+(5.009), (I-746)+(1.002)+(5.010), (I-746)+(1.002)+(5.011), (I-746)+(1.002)+(5.012), (I-746)+(1.002)+(5.013), (I-746)+(1.002)+(5.014), (I-746)+(1.002)+(5.015), (I-746)+(1.002)+(5.016), (I-746)+(1.002)+(5.017), (I-746)+(1.002)+(5.018), (I-746)+(1.002)+(5.019), (I-746)+(1.002)+(5.020), (I-746)+(1.002)+(5.021), (I-746)+(1.002)+(5.022), (I-746)+(1.002)+(5.023), (I-746)+(1.002)+(6.001), (I-746)+(1.002)+(6.002), (I-746)+(1.002)+(6.003), (I-746)+(1.002)+(6.004), (I-746)+(1.002)+(7.001), (I-746)+(1.002)+(7.002), (I-746)+(1.002)+(7.003), (I-746)+(1.002)+(7.004), (I-746)+(1.002)+(7.005), (I-746)+(1.002)+(7.006), (I-746)+(1.002)+(9.001), (I-746)+(1.002)+(9.002), (I-746)+(1.002)+(9.003), (I-746)+(1.002)+(9.004), (I-746)+(1.002)+(9.005), (I-746)+(1.002)+(9.006), (I-746)+(1.002)+(9.007), (I-746)+(1.002)+(9.008), (I-746)+(1.002)+(9.009), (I-746)+(1.002)+(14.001), (I-746)+(1.002)+(14.002), (I-746)+(1.002)+(15.008), (I-746)+(1.002)+(15.011), (I-746)+(1.002)+(15.012), (I-746)+(1.002)+(15.016), (I-746)+(1.002)+(15.025), (I-746)+(1.002)+(15.027), (I-746)+(1.002)+(15.047), (I-746)+(1.002)+(15.063), (I-746)+(1.002)+(15.064), (I-746)+(1.002)+(16.001), (I-746)+(1.002)+(16.002), (I-746)+(1.002)+(16.003), (I-746)+(1.002)+(16.004), (I-746)+(1.002)+(16.005), (I-746)+(1.002)+(16.006), (I-746)+(1.002)+(16.007), (I-746)+(1.002)+(16.008), (I-746)+(1.002)+(17.001), (I-746)+(1.002)+(17.002), (I-746)+(1.002)+(17.003), (I-746)+(1.002)+(17.004), (I-746)+(1.002)+(17.005), (I-746)+(1.002)+(17.006), (I-746)+(1.002)+(17.007), (I-746)+(1.002)+(17.008), (I-746)+(1.002)+(17.009), (I-746)+(1.002)+(17.010), (I-746)+(1.002)+(17.011), (I-746)+(1.002)+(17.012), (I-746)+(1.002)+(18.001),

(I-746)+(1.003)+(1.004), (I-746)+(1.003)+(1.005), (I-746)+(1.003)+(1.006), (I-746)+(1.003)+(1.007), (I-746)+(1.003)+(1.008), (I-746)+(1.003)+(1.009), (I-746)+(1.003)+(1.010), (I-746)+(1.003)+(1.011), (I-746)+(1.003)+(1.012), (I-746)+(1.003)+(1.013), (I-746)+(1.003)+(1.014), (I-746)+(1.003)+(1.015), (I-746)+(1.003)+(1.016), (I-746)+(1.003)+(1.017), (I-746)+(1.003)+(1.018), (I-746)+(1.003)+(1.019), (I-746)+(1.003)+(1.020), (I-746)+(1.003)+(1.021), (I-746)+(1.003)+(1.022), (I-746)+(1.003)+(1.023), (I-746)+(1.003)+(1.024), (I-746)+(1.003)+(1.025), (I-746)+(1.003)+(1.026), (I-746)+(1.003)+(1.027), (I-746)+(1.003)+(1.028), (I-746)+(1.003)+(1.029), (I-746)+(1.003)+(1.030), (I-746)+(1.003)+(1.031), (I-746)+(1.003)+(1.032), (I-746)+(1.003)+(1.033), (I-746)+(1.003)+(1.034), (I-746)+(1.003)+(1.035), (I-746)+(1.003)+(1.036), (I-746)+(1.003)+(1.037), (I-746)+(1.003)+(1.038), (I-746)+(1.003)+(1.039), (I-746)+(1.003)+(1.040), (I-746)+(1.003)+(1.041), (I-746)+(1.003)+(1.042), (I-746)+(1.003)+(1.043), (I-746)+(1.003)+(1.044), (I-746)+(1.003)+(1.045), (I-746)+(1.003)+(1.046), (I-746)+(1.003)+(1.047), (I-746)+(1.003)+(1.048), (I-746)+(1.003)+(1.049), (I-746)+(1.003)+(1.050), (I-746)+(1.003)+(1.051), (I-746)+(1.003)+(1.052), (I-746)+(1.003)+(1.053), (I-746)+(1.003)+(1.054), (I-746)+(1.003)+(1.055), (I-746)+(1.003)+(1.056), (I-746)+(1.003)+(1.057), (I-746)+(1.003)+(1.058), (I-746)+(1.003)+(1.059), (I-746)+(1.003)+(1.060), (I-746)+(1.003)+(1.061), (I-746)+(1.003)+(1.062), (I-746)+(1.003)+(1.063), (I-746)+(1.003)+(1.064), (I-746)+(1.003)+(1.065), (I-746)+(1.003)+(1.066), (I-746)+(1.003)+(1.067), (I-746)+(1.003)+(1.068), (I-746)+(1.003)+(1.069), (I-746)+(1.003)+(1.070), (I-746)+(1.003)+(1.071), (I-746)+(1.003)+(1.072), (I-746)+(1.003)+(1.073), (I-746)+(1.003)+(1.074), (I-746)+(1.003)+(1.075), (I-746)+(1.003)+(1.076), (I-746)+(1.003)+(1.077), (I-746)+(1.003)+(1.078), (I-746)+(1.003)+(1.079), (I-746)+(1.003)+(1.080), (I-746)+(1.003)+(1.081), (I-746)+(1.003)+(1.082), (I-746)+(1.003)+(1.083), (I-746)+(1.003)+(1.084), (I-746)+(1.003)+(1.085), (I-746)+(1.003)+(1.086), (I-746)+(1.003)+(1.087), (I-746)+(1.003)+(1.088), (I-746)+(1.003)+(1.089), (I-746)+(1.003)+(1.090), (I-746)+(1.003)+(1.091), (I-746)+(1.003)+(1.092), (I-746)+(1.003)+(2.001), (I-746)+(1.003)+(2.002), (I-746)+(1.003)+(2.003), (I-746)+(1.003)+(2.004), (I-746)+(1.003)+(2.005), (I-746)+(1.003)+(2.006), (I-746)+(1.003)+(2.007), (I-746)+(1.003)+(2.008), (I-746)+(1.003)+(2.009), (I-746)+(1.003)+(2.010), (I-746)+(1.003)+(2.011), (I-746)+(1.003)+(2.012), (I-746)+(1.003)+(2.013), (I-746)+(1.003)+(2.014), (I-746)+(1.003)+(2.015), (I-746)+(1.003)+(2.016), (I-746)+(1.003)+(2.017), (I-746)+(1.003)+(2.018), (I-746)+(1.003)+(2.019), (I-746)+(1.003)+(2.020), (I-746)+(1.003)+(2.021), (I-746)+(1.003)+(2.022), (I-746)+(1.003)+(2.023), (I-746)+(1.003)+(2.024), (I-746)+(1.003)+(2.025), (I-746)+(1.003)+(2.026), (I-746)+(1.003)+(2.027), (I-746)+(1.003)+(2.028), (I-746)+(1.003)+(2.029), (I-746)+(1.003)+(2.030), (I-746)+(1.003)+(2.031), (I-746)+(1.003)+(2.032), (I-746)+(1.003)+(2.033), (I-746)+(1.003)+(2.034), (I-746)+(1.003)+(2.035), (I-746)+(1.003)+(2.036), (I-746)+(1.003)+(2.037), (I-746)+(1.003)+(2.038), (I-746)+(1.003)+(2.039), (I-746)+(1.003)+(2.040), (I-746)+(1.003)+(2.041), (I-746)+(1.003)+(2.042), (I-746)+(1.003)+(2.043), (I-746)+(1.003)+(2.044), (I-746)+(1.003)+(2.045), (I-746)+(1.003)+(2.046), (I-746)+(1.003)+(2.047), (I-746)+(1.003)+(2.048), (I-746)+(1.003)+(2.049), (I-746)+(1.003)+(2.050), (I-746)+(1.003)+(2.051), (I-746)+(1.003)+(2.052), (I-746)+(1.003)+(2.053), (I-746)+(1.003)+(2.054), (I-746)+(1.003)+(2.055), (I-746)+(1.003)+(2.056), (I-746)+(1.003)+(2.057), (I-746)+(1.003)+(2.058), (I-746)+(1.003)+(2.059), (I-746)+(1.003)+(3.001), (I-746)+(1.003)+(3.002), (I-746)+(1.003)+(3.003), (I-746)+(1.003)+(3.004), (I-746)+(1.003)+(3.005), (I-746)+(1.003)+(3.006), (I-746)+(1.003)+(3.007), (I-746)+(1.003)+(3.008), (I-746)+(1.003)+(3.009), (I-746)+(1.003)+(3.010), (I-746)+(1.003)+(3.011), (I-746)+(1.003)+(3.012), (I-746)+(1.003)+(3.013), (I-746)+(1.003)+(3.014), (I-746)+(1.003)+(3.015), (I-746)+(1.003)+(3.016), (I-746)+(1.003)+(3.017), (I-746)+(1.003)+(3.018), (I-746)+(1.003)+(3.019), (I-746)+(1.003)+(3.020), (I-746)+(1.003)+(3.021), (I-746)+(1.003)+(3.022), (I-746)+(1.003)+(3.023), (I-746)+(1.003)+(3.024), (I-746)+(1.003)+(3.025), (I-746)+(1.003)+(3.026), (I-746)+(1.003)+(3.027), (I-746)+(1.003)+(3.028), (I-746)+(1.003)+(3.029), (I-746)+(1.003)+(3.030), (I-746)+(1.003)+(3.031), (I-746)+(1.003)+(5.001), (I-746)+(1.003)+(5.002), (I-746)+(1.003)+(5.003), (I-746)+(1.003)+(5.004), (I-746)+(1.003)+(5.005), (I-746)+(1.003)+(5.006), (I-746)+(1.003)+(5.007), (I-746)+(1.003)+(5.008), (I-746)+(1.003)+(5.009), (I-746)+(1.003)+(5.010), (I-746)+(1.003)+(5.011), (I-746)+(1.003)+(5.012), (I-746)+(1.003)+(5.013), (I-746)+(1.003)+(5.014), (I-746)+(1.003)+(5.015), (I-746)+(1.003)+(5.016), (I-746)+(1.003)+(5.017), (I-746)+(1.003)+(5.018), (I-746)+(1.003)+(5.019), (I-746)+(1.003)+(5.020), (I-746)+(1.003)+(5.021), (I-746)+(1.003)+(5.022), (I-746)+(1.003)+(5.023), (I-746)+(1.003)+(6.001), (I-746)+(1.003)+(6.002), (I-746)+(1.003)+(6.003), (I-746)+(1.003)+(6.004), (I-746)+(1.003)+(7.001), (I-746)+(1.003)+(7.002), (I-746)+(1.003)+(7.003), (I-746)+(1.003)+(7.004), (I-746)+(1.003)+(7.005), (I-746)+(1.003)+(7.006), (I-746)+(1.003)+(9.001), (I-746)+(1.003)+(9.002), (I-746)+(1.003)+(9.003), (I-746)+(1.003)+(9.004), (I-746)+(1.003)+(9.005), (I-746)+(1.003)+(9.006), (I-746)+(1.003)+(9.007), (I-746)+(1.003)+(9.008), (I-746)+(1.003)+(9.009), (I-746)+(1.003)+(14.001), (I-746)+(1.003)+(14.002), (I-746)+(1.003)+(15.008), (I-746)+(1.003)+(15.011), (I-746)+(1.003)+(15.012), (I-746)+(1.003)+(15.016), (I-746)+(1.003)+(15.025), (I-746)+(1.003)+(15.027), (I-746)+(1.003)+(15.047), (I-746)+(1.003)+(15.063), (I-746)+(1.003)+(15.064), (I-746)+(1.003)+(16.001), (I-746)+(1.003)+(16.002), (I-746)+(1.003)+(16.003), (I-746)+(1.003)+(16.004), (I-746)+(1.003)+(16.005), (I-746)+(1.003)+(16.006), (I-746)+(1.003)+(16.007), (I-746)+(1.003)+(16.008), (I-746)+(1.003)+(17.001), (I-746)+(1.003)+(17.002), (I-746)+(1.003)+(17.003), (I-746)+(1.003)+(17.004), (I-746)+(1.003)+(17.005), (I-746)+(1.003)+(17.006), (I-746)+(1.003)+(17.007), (I-746)+(1.003)+(17.008), (I-746)+(1.003)+(17.009), (I-746)+(1.003)+(17.010), (I-746)+(1.003)+(17.011), (I-746)+(1.003)+(17.012), (I-746)+(1.003)+(18.001),

(I-746)+(1.004)+(1.005), (I-746)+(1.004)+(1.006), (I-746)+(1.004)+(1.007), (I-746)+(1.004)+(1.008), (I-746)+(1.004)+(1.009), (I-746)+(1.004)+(1.010), (I-746)+(1.004)+(1.011), (I-746)+(1.004)+(1.012), (I-746)+(1.004)+(1.013), (I-746)+(1.004)+(1.014), (I-746)+(1.004)+(1.015), (I-746)+(1.004)+(1.016), (I-746)+(1.004)+(1.017), (I-746)+(1.004)+(1.018), (I-746)+(1.004)+(1.019), (I-746)+(1.004)+(1.020), (I-746)+(1.004)+(1.021), (I-746)+(1.004)+(1.022), (I-746)+(1.004)+(1.023), (I-746)+(1.004)+(1.024), (I-746)+(1.004)+(1.025), (I-746)+(1.004)+(1.026), (I-746)+(1.004)+(1.027), (I-746)+(1.004)+(1.028), (I-746)+(1.004)+(1.029), (I-746)+(1.004)+(1.030), (I-746)+(1.004)+(1.031), (I-746)+(1.004)+(1.032), (I-746)+(1.004)+(1.033), (I-746)+(1.004)+(1.034), (I-746)+(1.004)+(1.035), (I-746)+(1.004)+(1.036), (I-746)+(1.004)+(1.037), (I-746)+(1.004)+(1.038), (I-746)+(1.004)+(1.039), (I-746)+(1.004)+(1.040), (I-746)+(1.004)+(1.041), (I-746)+(1.004)+(1.042), (I-746)+(1.004)+(1.043), (I-746)+(1.004)+(1.044), (I-746)+(1.004)+(1.045), (I-746)+(1.004)+(1.046), (I-746)+(1.004)+(1.047), (I-746)+(1.004)+(1.048), (I-746)+(1.004)+(1.049), (I-746)+(1.004)+(1.050), (I-746)+(1.004)+(1.051), (I-746)+(1.004)+(1.052), (I-746)+(1.004)+(1.053), (I-746)+(1.004)+(1.054), (I-746)+(1.004)+(1.055), (I-746)+(1.004)+(1.056), (I-746)+(1.004)+(1.057), (I-746)+(1.004)+(1.058), (I-746)+(1.004)+(1.059), (I-746)+(1.004)+(1.060), (I-746)+(1.004)+(1.061), (I-746)+(1.004)+(1.062), (I-746)+(1.004)+(1.063), (I-746)+(1.004)+(1.064), (I-746)+(1.004)+(1.065), (I-746)+(1.004)+(1.066), (I-746)+(1.004)+(1.067), (I-746)+(1.004)+(1.068), (I-746)+(1.004)+(1.069), (I-746)+(1.004)+(1.070), (I-746)+(1.004)+(1.071), (I-746)+(1.004)+(1.072), (I-746)+(1.004)+(1.073), (I-746)+(1.004)+(1.074), (I-746)+(1.004)+(1.075), (I-746)+(1.004)+(1.076), (I-746)+(1.004)+(1.077), (I-746)+(1.004)+(1.078), (I-746)+(1.004)+(1.079), (I-746)+(1.004)+(1.080), (I-746)+(1.004)+(1.081), (I-746)+(1.004)+(1.082), (I-746)+(1.004)+(1.083), (I-746)+(1.004)+(1.084), (I-746)+(1.004)+(1.085), (I-746)+(1.004)+(1.086), (I-746)+(1.004)+(1.087), (I-746)+(1.004)+(1.088), (I-746)+(1.004)+(1.089), (I-746)+(1.004)+(1.090), (I-746)+(1.004)+(1.091), (I-746)+(1.004)+(1.092), (I-746)+(1.004)+(2.001), (I-746)+(1.004)+(2.002), (I-746)+(1.004)+(2.003), (I-746)+(1.004)+(2.004), (I-746)+(1.004)+(2.005), (I-746)+(1.004)+(2.006), (I-746)+(1.004)+(2.007), (I-746)+(1.004)+(2.008), (I-746)+(1.004)+(2.009), (I-746)+(1.004)+(2.010), (I-746)+(1.004)+(2.011), (I-746)+(1.004)+(2.012), (I-746)+(1.004)+(2.013), (I-746)+(1.004)+(2.014), (I-746)+(1.004)+(2.015), (I-746)+(1.004)+(2.016), (I-746)+(1.004)+(2.017), (I-746)+(1.004)+(2.018), (I-746)+(1.004)+(2.019), (I-746)+(1.004)+(2.020), (I-746)+(1.004)+(2.021), (I-746)+(1.004)+(2.022), (I-746)+(1.004)+(2.023), (I-746)+(1.004)+(2.024), (I-746)+(1.004)+(2.025), (I-746)+(1.004)+(2.026), (I-746)+(1.004)+(2.027), (I-746)+(1.004)+(2.028), (I-746)+(1.004)+(2.029), (I-746)+(1.004)+(2.030), (I-746)+(1.004)+(2.031), (I-746)+(1.004)+(2.032), (I-746)+(1.004)+(2.033), (I-746)+(1.004)+(2.034), (I-746)+(1.004)+(2.035), (I-746)+(1.004)+(2.036), (I-746)+(1.004)+(2.037), (I-746)+(1.004)+(2.038), (I-746)+(1.004)+(2.039), (I-746)+(1.004)+(2.040), (I-746)+(1.004)+(2.041), (I-746)+(1.004)+(2.042), (I-746)+(1.004)+(2.043), (I-746)+(1.004)+(2.044), (I-746)+(1.004)+(2.045), (I-746)+(1.004)+(2.046), (I-746)+(1.004)+(2.047), (I-746)+(1.004)+(2.048), (I-746)+(1.004)+(2.049), (I-746)+(1.004)+(2.050), (I-746)+(1.004)+(2.051), (I-746)+(1.004)+(2.052), (I-746)+(1.004)+(2.053), (I-746)+(1.004)+(2.054), (I-746)+(1.004)+(2.055), (I-746)+(1.004)+(2.056), (I-746)+(1.004)+(2.057), (I-746)+(1.004)+(2.058), (I-746)+(1.004)+(2.059), (I-746)+(1.004)+(3.001), (I-746)+(1.004)+(3.002), (I-746)+(1.004)+(3.003), (I-746)+(1.004)+(3.004), (I-746)+(1.004)+(3.005), (I-746)+(1.004)+(3.006), (I-746)+(1.004)+(3.007), (I-746)+(1.004)+(3.008), (I-746)+(1.004)+(3.009), (I-746)+(1.004)+(3.010), (I-746)+(1.004)+(3.011), (I-746)+(1.004)+(3.012), (I-746)+(1.004)+(3.013), (I-746)+(1.004)+(3.014), (I-746)+(1.004)+(3.015), (I-746)+(1.004)+(3.016), (I-746)+(1.004)+(3.017), (I-746)+(1.004)+(3.018), (I-746)+(1.004)+(3.019), (I-746)+(1.004)+(3.020), (I-746)+(1.004)+(3.021), (I-746)+(1.004)+(3.022), (I-746)+(1.004)+(3.023), (I-746)+(1.004)+(3.024), (I-746)+(1.004)+(3.025), (I-746)+(1.004)+(3.026), (I-746)+(1.004)+(3.027), (I-746)+(1.004)+(3.028), (I-746)+(1.004)+(3.029), (I-746)+(1.004)+(3.030), (I-746)+(1.004)+(3.031), (I-746)+(1.004)+(5.001), (I-746)+(1.004)+(5.002), (I-746)+(1.004)+(5.003), (I-746)+(1.004)+(5.004), (I-746)+(1.004)+(5.005), (I-746)+(1.004)+(5.006), (I-746)+(1.004)+(5.007), (I-746)+(1.004)+(5.008), (I-746)+(1.004)+(5.009), (I-746)+(1.004)+(5.010), (I-746)+(1.004)+(5.011), (I-746)+(1.004)+(5.012), (I-746)+(1.004)+(5.013), (I-746)+(1.004)+(5.014), (I-746)+(1.004)+(5.015), (I-746)+(1.004)+(5.016), (I-746)+(1.004)+(5.017), (I-746)+(1.004)+(5.018), (I-746)+(1.004)+(5.019), (I-746)+(1.004)+(5.020), (I-746)+(1.004)+(5.021), (I-746)+(1.004)+(5.022), (I-746)+(1.004)+(5.023), (I-746)+(1.004)+(6.001), (I-746)+(1.004)+(6.002), (I-746)+(1.004)+(6.003), (I-746)+(1.004)+(6.004), (I-746)+(1.004)+(7.001), (I-746)+(1.004)+(7.002), (I-746)+(1.004)+(7.003), (I-746)+(1.004)+(7.004), (I-746)+(1.004)+(7.005), (I-746)+(1.004)+(7.006), (I-746)+(1.004)+(9.001), (I-746)+(1.004)+(9.002), (I-746)+(1.004)+(9.003), (I-746)+(1.004)+(9.004), (I-746)+(1.004)+(9.005), (I-746)+(1.004)+(9.006), (I-746)+(1.004)+(9.007), (I-746)+(1.004)+(9.008), (I-746)+(1.004)+(9.009), (I-746)+(1.004)+(14.001), (I-746)+(1.004)+(14.002), (I-746)+(1.004)+(15.008), (I-746)+(1.004)+(15.011), (I-746)+(1.004)+(15.012), (I-746)+(1.004)+(15.016), (I-746)+(1.004)+(15.025), (I-746)+(1.004)+(15.027), (I-746)+(1.004)+(15.047), (I-746)+(1.004)+(15.063), (I-746)+(1.004)+(15.064), (I-746)+(1.004)+(16.001), (I-746)+(1.004)+(16.002), (I-746)+(1.004)+(16.003), (I-746)+(1.004)+(16.004), (I-746)+(1.004)+(16.005), (I-746)+(1.004)+(16.006), (I-746)+(1.004)+(16.007), (I-746)+(1.004)+(16.008), (I-746)+(1.004)+(17.001), (I-746)+(1.004)+(17.002), (I-746)+(1.004)+(17.003), (I-746)+(1.004)+(17.004), (I-746)+(1.004)+(17.005), (I-746)+(1.004)+(17.006), (I-746)+(1.004)+(17.007), (I-746)+(1.004)+(17.008), (I-746)+(1.004)+(17.009), (I-746)+(1.004)+(17.010), (I-746)+(1.004)+(17.011), (I-746)+(1.004)+(17.012), (I-746)+(1.004)+(18.001),

(I-746)+(1.005)+(1.006), (I-746)+(1.005)+(1.007), (I-746)+(1.005)+(1.008), (I-746)+(1.005)+(1.009), (I-746)+(1.005)+(1.010), (I-746)+(1.005)+(1.011), (I-746)+(1.005)+(1.012), (I-746)+(1.005)+(1.013), (I-746)+(1.005)+(1.014), (I-746)+(1.005)+(1.015), (I-746)+(1.005)+(1.016), (I-746)+(1.005)+(1.017), (I-746)+(1.005)+(1.018), (I-746)+(1.005)+(1.019), (I-746)+(1.005)+(1.020), (I-746)+(1.005)+(1.021), (I-746)+(1.005)+(1.022), (I-746)+(1.005)+(1.023), (I-746)+(1.005)+(1.024), (I-746)+(1.005)+(1.025), (I-746)+(1.005)+(1.026), (I-746)+(1.005)+(1.027), (I-746)+(1.005)+(1.028), (I-746)+(1.005)+(1.029), (I-746)+(1.005)+(1.030), (I-746)+(1.005)+(1.031), (I-746)+(1.005)+(1.032), (I-746)+(1.005)+(1.033), (I-746)+(1.005)+(1.034), (I-746)+(1.005)+(1.035), (I-746)+(1.005)+(1.036), (I-746)+(1.005)+(1.037), (I-746)+(1.005)+(1.038), (I-746)+(1.005)+(1.039), (I-746)+(1.005)+(1.040), (I-746)+(1.005)+(1.041), (I-746)+(1.005)+(1.042), (I-746)+(1.005)+(1.043), (I-746)+(1.005)+(1.044), (I-746)+(1.005)+(1.045), (I-746)+(1.005)+(1.046), (I-746)+(1.005)+(1.047), (I-746)+(1.005)+(1.048), (I-746)+(1.005)+(1.049), (I-746)+(1.005)+(1.050), (I-746)+(1.005)+(1.051), (I-746)+(1.005)+(1.052), (I-746)+(1.005)+(1.053), (I-746)+(1.005)+(1.054), (I-746)+(1.005)+(1.055), (I-746)+(1.005)+(1.056), (I-746)+(1.005)+(1.057), (I-746)+(1.005)+(1.058), (I-746)+(1.005)+(1.059), (I-746)+(1.005)+(1.060), (I-746)+(1.005)+(1.061), (I-746)+(1.005)+(1.062), (I-746)+(1.005)+(1.063), (I-746)+(1.005)+(1.064), (I-746)+(1.005)+(1.065), (I-746)+(1.005)+(1.066), (I-746)+(1.005)+(1.067), (I-746)+(1.005)+(1.068), (I-746)+(1.005)+(1.069), (I-746)+(1.005)+(1.070), (I-746)+(1.005)+(1.071), (I-746)+(1.005)+(1.072), (I-746)+(1.005)+(1.073), (I-746)+(1.005)+(1.074), (I-746)+(1.005)+(1.075), (I-746)+(1.005)+(1.076), (I-746)+(1.005)+(1.077), (I-746)+(1.005)+(1.078), (I-746)+(1.005)+(1.079), (I-746)+(1.005)+(1.080), (I-746)+(1.005)+(1.081), (I-746)+(1.005)+(1.082), (I-746)+(1.005)+(1.083), (I-746)+(1.005)+(1.084), (I-746)+(1.005)+(1.085), (I-746)+(1.005)+(1.086), (I-746)+(1.005)+(1.087), (I-746)+(1.005)+(1.088), (I-746)+(1.005)+(1.089), (I-746)+(1.005)+(1.090), (I-746)+(1.005)+(1.091), (I-746)+(1.005)+(1.092), (I-746)+(1.005)+(2.001), (I-746)+(1.005)+(2.002), (I-746)+(1.005)+(2.003), (I-746)+(1.005)+(2.004), (I-746)+(1.005)+(2.005), (I-746)+(1.005)+(2.006), (I-746)+(1.005)+(2.007), (I-746)+(1.005)+(2.008), (I-746)+(1.005)+(2.009), (I-746)+(1.005)+(2.010), (I-746)+(1.005)+(2.011), (I-746)+(1.005)+(2.012), (I-746)+(1.005)+(2.013), (I-746)+(1.005)+(2.014), (I-746)+(1.005)+(2.015), (I-746)+(1.005)+(2.016), (I-746)+(1.005)+(2.017), (I-746)+(1.005)+(2.018), (I-746)+(1.005)+(2.019), (I-746)+(1.005)+(2.020), (I-746)+(1.005)+(2.021), (I-746)+(1.005)+(2.022), (I-746)+(1.005)+(2.023), (I-746)+(1.005)+(2.024), (I-746)+(1.005)+(2.025), (I-746)+(1.005)+(2.026), (I-746)+(1.005)+(2.027), (I-746)+(1.005)+(2.028), (I-746)+(1.005)+(2.029), (I-746)+(1.005)+(2.030), (I-746)+(1.005)+(2.031), (I-746)+(1.005)+(2.032), (I-746)+(1.005)+(2.033), (I-746)+(1.005)+(2.034), (I-746)+(1.005)+(2.035), (I-746)+(1.005)+(2.036), (I-746)+(1.005)+(2.037), (I-746)+(1.005)+(2.038), (I-746)+(1.005)+(2.039), (I-746)+(1.005)+(2.040), (I-746)+(1.005)+(2.041), (I-746)+(1.005)+(2.042), (I-746)+(1.005)+(2.043), (I-746)+(1.005)+(2.044), (I-746)+(1.005)+(2.045), (I-746)+(1.005)+(2.046), (I-746)+(1.005)+(2.047), (I-746)+(1.005)+(2.048), (I-746)+(1.005)+(2.049), (I-746)+(1.005)+(2.050), (I-746)+(1.005)+(2.051), (I-746)+(1.005)+(2.052), (I-746)+(1.005)+(2.053), (I-746)+(1.005)+(2.054), (I-746)+(1.005)+(2.055), (I-746)+(1.005)+(2.056), (I-746)+(1.005)+(2.057), (I-746)+(1.005)+(2.058), (I-746)+(1.005)+(2.059), (I-746)+(1.005)+(3.001), (I-746)+(1.005)+(3.002), (I-746)+(1.005)+(3.003), (I-746)+(1.005)+(3.004), (I-746)+(1.005)+(3.005), (I-746)+(1.005)+(3.006), (I-746)+(1.005)+(3.007), (I-746)+(1.005)+(3.008), (I-746)+(1.005)+(3.009), (I-746)+(1.005)+(3.010), (I-746)+(1.005)+(3.011), (I-746)+(1.005)+(3.012), (I-746)+(1.005)+(3.013), (I-746)+(1.005)+(3.014), (I-746)+(1.005)+(3.015), (I-746)+(1.005)+(3.016), (I-746)+(1.005)+(3.017), (I-746)+(1.005)+(3.018), (I-746)+(1.005)+(3.019), (I-746)+(1.005)+(3.020), (I-746)+(1.005)+(3.021), (I-746)+(1.005)+(3.022), (I-746)+(1.005)+(3.023), (I-746)+(1.005)+(3.024), (I-746)+(1.005)+(3.025), (I-746)+(1.005)+(3.026), (I-746)+(1.005)+(3.027), (I-746)+(1.005)+(3.028), (I-746)+(1.005)+(3.029), (I-746)+(1.005)+(3.030), (I-746)+(1.005)+(3.031), (I-746)+(1.005)+(5.001), (I-746)+(1.005)+(5.002), (I-746)+(1.005)+(5.003), (I-746)+(1.005)+(5.004), (I-746)+(1.005)+(5.005), (I-746)+(1.005)+(5.006), (I-746)+(1.005)+(5.007), (I-746)+(1.005)+(5.008), (I-746)+(1.005)+(5.009), (I-746)+(1.005)+(5.010), (I-746)+(1.005)+(5.011), (I-746)+(1.005)+(5.012), (I-746)+(1.005)+(5.013), (I-746)+(1.005)+(5.014), (I-746)+(1.005)+(5.015), (I-746)+(1.005)+(5.016), (I-746)+(1.005)+(5.017), (I-746)+(1.005)+(5.018), (I-746)+(1.005)+(5.019), (I-746)+(1.005)+(5.020), (I-746)+(1.005)+(5.021), (I-746)+(1.005)+(5.022), (I-746)+(1.005)+(5.023), (I-746)+(1.005)+(6.001), (I-746)+(1.005)+(6.002), (I-746)+(1.005)+(6.003), (I-746)+(1.005)+(6.004), (I-746)+(1.005)+(7.001), (I-746)+(1.005)+(7.002), (I-746)+(1.005)+(7.003), (I-746)+(1.005)+(7.004), (I-746)+(1.005)+(7.005), (I-746)+(1.005)+(7.006), (I-746)+(1.005)+(9.001), (I-746)+(1.005)+(9.002), (I-746)+(1.005)+(9.003), (I-746)+(1.005)+(9.004), (I-746)+(1.005)+(9.005), (I-746)+(1.005)+(9.006), (I-746)+(1.005)+(9.007), (I-746)+(1.005)+(9.008), (I-746)+(1.005)+(9.009), (I-746)+(1.005)+(14.001), (I-746)+(1.005)+(14.002), (I-746)+(1.005)+(15.008), (I-746)+(1.005)+(15.011), (I-746)+(1.005)+(15.012), (I-746)+(1.005)+(15.016), (I-746)+(1.005)+(15.025), (I-746)+(1.005)+(15.027), (I-746)+(1.005)+(15.047), (I-746)+(1.005)+(15.063), (I-746)+(1.005)+(15.064), (I-746)+(1.005)+(16.001), (I-746)+(1.005)+(16.002), (I-746)+(1.005)+(16.003), (I-746)+(1.005)+(16.004), (I-746)+(1.005)+(16.005), (I-746)+(1.005)+(16.006), (I-746)+(1.005)+(16.007), (I-746)+(1.005)+(16.008), (I-746)+(1.005)+(17.001), (I-746)+(1.005)+(17.002), (I-746)+(1.005)+(17.003), (I-746)+(1.005)+(17.004), (I-746)+(1.005)+(17.005), (I-746)+(1.005)+(17.006), (I-746)+(1.005)+(17.007), (I-746)+(1.005)+(17.008), (I-746)+(1.005)+(17.009), (I-746)+(1.005)+(17.010), (I-746)+(1.005)+(17.011), (I-746)+(1.005)+(17.012), (I-746)+(1.005)+(18.001),

(I-746)+(1.006)+(1.007), (I-746)+(1.006)+(1.008), (I-746)+(1.006)+(1.009), (I-746)+(1.006)+(1.010), (I-746)+(1.006)+(1.011), (I-746)+(1.006)+(1.012), (I-746)+(1.006)+(1.013), (I-746)+(1.006)+(1.014), (I-746)+(1.006)+(1.015), (I-746)+(1.006)+(1.016), (I-746)+(1.006)+(1.017), (I-746)+(1.006)+(1.018), (I-746)+(1.006)+(1.019), (I-746)+(1.006)+(1.020), (I-746)+(1.006)+(1.021), (I-746)+(1.006)+(1.022), (I-746)+(1.006)+(1.023), (I-746)+(1.006)+(1.024), (I-746)+(1.006)+(1.025), (I-746)+(1.006)+(1.026), (I-746)+(1.006)+(1.027), (I-746)+(1.006)+(1.028), (I-746)+(1.006)+(1.029), (I-746)+(1.006)+(1.030), (I-746)+(1.006)+(1.031), (I-746)+(1.006)+(1.032), (I-746)+(1.006)+(1.033), (I-746)+(1.006)+(1.034), (I-746)+(1.006)+(1.035), (I-746)+(1.006)+(1.036), (I-746)+(1.006)+(1.037), (I-746)+(1.006)+(1.038), (I-746)+(1.006)+(1.039), (I-746)+(1.006)+(1.040), (I-746)+(1.006)+(1.041), (I-746)+(1.006)+(1.042), (I-746)+(1.006)+(1.043), (I-746)+(1.006)+(1.044), (I-746)+(1.006)+(1.045), (I-746)+(1.006)+(1.046), (I-746)+(1.006)+(1.047), (I-746)+(1.006)+(1.048), (I-746)+(1.006)+(1.049), (I-746)+(1.006)+(1.050), (I-746)+(1.006)+(1.051), (I-746)+(1.006)+(1.052), (I-746)+(1.006)+(1.053), (I-746)+(1.006)+(1.054), (I-746)+(1.006)+(1.055), (I-746)+(1.006)+(1.056), (I-746)+(1.006)+(1.057), (I-746)+(1.006)+(1.058), (I-746)+(1.006)+(1.059), (I-746)+(1.006)+(1.060), (I-746)+(1.006)+(1.061), (I-746)+(1.006)+(1.062), (I-746)+(1.006)+(1.063), (I-746)+(1.006)+(1.064), (I-746)+(1.006)+(1.065), (I-746)+(1.006)+(1.066), (I-746)+(1.006)+(1.067), (I-746)+(1.006)+(1.068), (I-746)+(1.006)+(1.069), (I-746)+(1.006)+(1.070), (I-746)+(1.006)+(1.071), (I-746)+(1.006)+(1.072), (I-746)+(1.006)+(1.073), (I-746)+(1.006)+(1.074), (I-746)+(1.006)+(1.075), (I-746)+(1.006)+(1.076), (I-746)+(1.006)+(1.077), (I-746)+(1.006)+(1.078), (I-746)+(1.006)+(1.079), (I-746)+(1.006)+(1.080), (I-746)+(1.006)+(1.081), (I-746)+(1.006)+(1.082), (I-746)+(1.006)+(1.083), (I-746)+(1.006)+(1.084), (I-746)+(1.006)+(1.085), (I-746)+(1.006)+(1.086), (I-746)+(1.006)+(1.087), (I-746)+(1.006)+(1.088), (I-746)+(1.006)+(1.089), (I-746)+(1.006)+(1.090), (I-746)+(1.006)+(1.091), (I-746)+(1.006)+(1.092), (I-746)+(1.006)+(2.001), (I-746)+(1.006)+(2.002), (I-746)+(1.006)+(2.003), (I-746)+(1.006)+(2.004), (I-746)+(1.006)+(2.005), (I-746)+(1.006)+(2.006), (I-746)+(1.006)+(2.007), (I-746)+(1.006)+(2.008), (I-746)+(1.006)+(2.009), (I-746)+(1.006)+(2.010), (I-746)+(1.006)+(2.011), (I-746)+(1.006)+(2.012), (I-746)+(1.006)+(2.013), (I-746)+(1.006)+(2.014), (I-746)+(1.006)+(2.015), (I-746)+(1.006)+(2.016), (I-746)+(1.006)+(2.017), (I-746)+(1.006)+(2.018), (I-746)+(1.006)+(2.019), (I-746)+(1.006)+(2.020), (I-746)+(1.006)+(2.021), (I-746)+(1.006)+(2.022), (I-746)+(1.006)+(2.023), (I-746)+(1.006)+(2.024), (I-746)+(1.006)+(2.025), (I-746)+(1.006)+(2.026), (I-746)+(1.006)+(2.027), (I-746)+(1.006)+(2.028), (I-746)+(1.006)+(2.029), (I-746)+(1.006)+(2.030), (I-746)+(1.006)+(2.031), (I-746)+(1.006)+(2.032), (I-746)+(1.006)+(2.033), (I-746)+(1.006)+(2.034), (I-746)+(1.006)+(2.035), (I-746)+(1.006)+(2.036), (I-746)+(1.006)+(2.037), (I-746)+(1.006)+(2.038), (I-746)+(1.006)+(2.039), (I-746)+(1.006)+(2.040), (I-746)+(1.006)+(2.041), (I-746)+(1.006)+(2.042), (I-746)+(1.006)+(2.043), (I-746)+(1.006)+(2.044), (I-746)+(1.006)+(2.045), (I-746)+(1.006)+(2.046), (I-746)+(1.006)+(2.047), (I-746)+(1.006)+(2.048), (I-746)+(1.006)+(2.049), (I-746)+(1.006)+(2.050), (I-746)+(1.006)+(2.051), (I-746)+(1.006)+(2.052), (I-746)+(1.006)+(2.053), (I-746)+(1.006)+(2.054), (I-746)+(1.006)+(2.055), (I-746)+(1.006)+(2.056), (I-746)+(1.006)+(2.057), (I-746)+(1.006)+(2.058), (I-746)+(1.006)+(2.059), (I-746)+(1.006)+(3.001), (I-746)+(1.006)+(3.002), (I-746)+(1.006)+(3.003), (I-746)+(1.006)+(3.004), (I-746)+(1.006)+(3.005), (I-746)+(1.006)+(3.006), (I-746)+(1.006)+(3.007), (I-746)+(1.006)+(3.008), (I-746)+(1.006)+(3.009), (I-746)+(1.006)+(3.010), (I-746)+(1.006)+(3.011), (I-746)+(1.006)+(3.012), (I-746)+(1.006)+(3.013), (I-746)+(1.006)+(3.014), (I-746)+(1.006)+(3.015), (I-746)+(1.006)+(3.016), (I-746)+(1.006)+(3.017), (I-746)+(1.006)+(3.018), (I-746)+(1.006)+(3.019), (I-746)+(1.006)+(3.020), (I-746)+(1.006)+(3.021), (I-746)+(1.006)+(3.022), (I-746)+(1.006)+(3.023), (I-746)+(1.006)+(3.024), (I-746)+(1.006)+(3.025), (I-746)+(1.006)+(3.026), (I-746)+(1.006)+(3.027), (I-746)+(1.006)+(3.028), (I-746)+(1.006)+(3.029), (I-746)+(1.006)+(3.030), (I-746)+(1.006)+(3.031), (I-746)+(1.006)+(5.001), (I-746)+(1.006)+(5.002), (I-746)+(1.006)+(5.003), (I-746)+(1.006)+(5.004), (I-746)+(1.006)+(5.005), (I-746)+(1.006)+(5.006), (I-746)+(1.006)+(5.007), (I-746)+(1.006)+(5.008), (I-746)+(1.006)+(5.009), (I-746)+(1.006)+(5.010), (I-746)+(1.006)+(5.011), (I-746)+(1.006)+(5.012), (I-746)+(1.006)+(5.013), (I-746)+(1.006)+(5.014), (I-746)+(1.006)+(5.015), (I-746)+(1.006)+(5.016), (I-746)+(1.006)+(5.017), (I-746)+(1.006)+(5.018), (I-746)+(1.006)+(5.019), (I-746)+(1.006)+(5.020), (I-746)+(1.006)+(5.021), (I-746)+(1.006)+(5.022), (I-746)+(1.006)+(5.023), (I-746)+(1.006)+(6.001), (I-746)+(1.006)+(6.002), (I-746)+(1.006)+(6.003), (I-746)+(1.006)+(6.004), (I-746)+(1.006)+(7.001), (I-746)+(1.006)+(7.002), (I-746)+(1.006)+(7.003), (I-746)+(1.006)+(7.004), (I-746)+(1.006)+(7.005), (I-746)+(1.006)+(7.006), (I-746)+(1.006)+(9.001), (I-746)+(1.006)+(9.002), (I-746)+(1.006)+(9.003), (I-746)+(1.006)+(9.004), (I-746)+(1.006)+(9.005), (I-746)+(1.006)+(9.006), (I-746)+(1.006)+(9.007), (I-746)+(1.006)+(9.008), (I-746)+(1.006)+(9.009), (I-746)+(1.006)+(14.001), (I-746)+(1.006)+(14.002), (I-746)+(1.006)+(15.008), (I-746)+(1.006)+(15.011), (I-746)+(1.006)+(15.012), (I-746)+(1.006)+(15.016), (I-746)+(1.006)+(15.025), (I-746)+(1.006)+(15.027), (I-746)+(1.006)+(15.047), (I-746)+(1.006)+(15.063), (I-746)+(1.006)+(15.064), (I-746)+(1.006)+(16.001), (I-746)+(1.006)+(16.002), (I-746)+(1.006)+(16.003), (I-746)+(1.006)+(16.004), (I-746)+(1.006)+(16.005), (I-746)+(1.006)+(16.006), (I-746)+(1.006)+(16.007), (I-746)+(1.006)+(16.008), (I-746)+(1.006)+(17.001), (I-746)+(1.006)+(17.002), (I-746)+(1.006)+(17.003), (I-746)+(1.006)+(17.004), (I-746)+(1.006)+(17.005), (I-746)+(1.006)+(17.006), (I-746)+(1.006)+(17.007), (I-746)+(1.006)+(17.008), (I-746)+(1.006)+(17.009), (I-746)+(1.006)+(17.010), (I-746)+(1.006)+(17.011), (I-746)+(1.006)+(17.012), (I-746)+(1.006)+(18.001),

(I-746)+(1.007)+(1.008), (I-746)+(1.007)+(1.009), (I-746)+(1.007)+(1.010), (I-746)+(1.007)+(1.011), (I-746)+(1.007)+(1.012), (I-746)+(1.007)+(1.013), (I-746)+(1.007)+(1.014), (I-746)+(1.007)+(1.015), (I-746)+(1.007)+(1.016), (I-746)+(1.007)+(1.017), (I-746)+(1.007)+(1.018), (I-746)+(1.007)+(1.019), (I-746)+(1.007)+(1.020), (I-746)+(1.007)+(1.021), (I-746)+(1.007)+(1.022), (I-746)+(1.007)+(1.023), (I-746)+(1.007)+(1.024), (I-746)+(1.007)+(1.025), (I-746)+(1.007)+(1.026), (I-746)+(1.007)+(1.027), (I-746)+(1.007)+(1.028), (I-746)+(1.007)+(1.029), (I-746)+(1.007)+(1.030), (I-746)+(1.007)+(1.031), (I-746)+(1.007)+(1.032), (I-746)+(1.007)+(1.033), (I-746)+(1.007)+(1.034), (I-746)+(1.007)+(1.035), (I-746)+(1.007)+(1.036), (I-746)+(1.007)+(1.037), (I-746)+(1.007)+(1.038), (I-746)+(1.007)+(1.039), (I-746)+(1.007)+(1.040), (I-746)+(1.007)+(1.041), (I-746)+(1.007)+(1.042), (I-746)+(1.007)+(1.043), (I-746)+(1.007)+(1.044), (I-746)+(1.007)+(1.045), (I-746)+(1.007)+(1.046), (I-746)+(1.007)+(1.047), (I-746)+(1.007)+(1.048), (I-746)+(1.007)+(1.049), (I-746)+(1.007)+(1.050), (I-746)+(1.007)+(1.051), (I-746)+(1.007)+(1.052), (I-746)+(1.007)+(1.053), (I-746)+(1.007)+(1.054), (I-746)+(1.007)+(1.055), (I-746)+(1.007)+(1.056), (I-746)+(1.007)+(1.057), (I-746)+(1.007)+(1.058), (I-746)+(1.007)+(1.059), (I-746)+(1.007)+(1.060), (I-746)+(1.007)+(1.061), (I-746)+(1.007)+(1.062), (I-746)+(1.007)+(1.063), (I-746)+(1.007)+(1.064), (I-746)+(1.007)+(1.065), (I-746)+(1.007)+(1.066), (I-746)+(1.007)+(1.067), (I-746)+(1.007)+(1.068), (I-746)+(1.007)+(1.069), (I-746)+(1.007)+(1.070), (I-746)+(1.007)+(1.071), (I-746)+(1.007)+(1.072), (I-746)+(1.007)+(1.073), (I-746)+(1.007)+(1.074), (I-746)+(1.007)+(1.075), (I-746)+(1.007)+(1.076), (I-746)+(1.007)+(1.077), (I-746)+(1.007)+(1.078), (I-746)+(1.007)+(1.079), (I-746)+(1.007)+(1.080), (I-746)+(1.007)+(1.081), (I-746)+(1.007)+(1.082), (I-746)+(1.007)+(1.083), (I-746)+(1.007)+(1.084), (I-746)+(1.007)+(1.085), (I-746)+(1.007)+(1.086), (I-746)+(1.007)+(1.087), (I-746)+(1.007)+(1.088), (I-746)+(1.007)+(1.089), (I-746)+(1.007)+(1.090), (I-746)+(1.007)+(1.091), (I-746)+(1.007)+(1.092), (I-746)+(1.007)+(2.001), (I-746)+(1.007)+(2.002), (I-746)+(1.007)+(2.003), (I-746)+(1.007)+(2.004), (I-746)+(1.007)+(2.005), (I-746)+(1.007)+(2.006), (I-746)+(1.007)+(2.007), (I-746)+(1.007)+(2.008), (I-746)+(1.007)+(2.009), (I-746)+(1.007)+(2.010), (I-746)+(1.007)+(2.011), (I-746)+(1.007)+(2.012), (I-746)+(1.007)+(2.013), (I-746)+(1.007)+(2.014), (I-746)+(1.007)+(2.015), (I-746)+(1.007)+(2.016), (I-746)+(1.007)+(2.017), (I-746)+(1.007)+(2.018), (I-746)+(1.007)+(2.019), (I-746)+(1.007)+(2.020), (I-746)+(1.007)+(2.021), (I-746)+(1.007)+(2.022), (I-746)+(1.007)+(2.023), (I-746)+(1.007)+(2.024), (I-746)+(1.007)+(2.025), (I-746)+(1.007)+(2.026), (I-746)+(1.007)+(2.027), (I-746)+(1.007)+(2.028), (I-746)+(1.007)+(2.029), (I-746)+(1.007)+(2.030), (I-746)+(1.007)+(2.031), (I-746)+(1.007)+(2.032), (I-746)+(1.007)+(2.033), (I-746)+(1.007)+(2.034), (I-746)+(1.007)+(2.035), (I-746)+(1.007)+(2.036), (I-746)+(1.007)+(2.037), (I-746)+(1.007)+(2.038), (I-746)+(1.007)+(2.039), (I-746)+(1.007)+(2.040), (I-746)+(1.007)+(2.041), (I-746)+(1.007)+(2.042), (I-746)+(1.007)+(2.043), (I-746)+(1.007)+(2.044), (I-746)+(1.007)+(2.045), (I-746)+(1.007)+(2.046), (I-746)+(1.007)+(2.047), (I-746)+(1.007)+(2.048), (I-746)+(1.007)+(2.049), (I-746)+(1.007)+(2.050), (I-746)+(1.007)+(2.051), (I-746)+(1.007)+(2.052), (I-746)+(1.007)+(2.053), (I-746)+(1.007)+(2.054), (I-746)+(1.007)+(2.055), (I-746)+(1.007)+(2.056), (I-746)+(1.007)+(2.057), (I-746)+(1.007)+(2.058), (I-746)+(1.007)+(2.059), (I-746)+(1.007)+(3.001), (I-746)+(1.007)+(3.002), (I-746)+(1.007)+(3.003), (I-746)+(1.007)+(3.004), (I-746)+(1.007)+(3.005), (I-746)+(1.007)+(3.006), (I-746)+(1.007)+(3.007), (I-746)+(1.007)+(3.008), (I-746)+(1.007)+(3.009), (I-746)+(1.007)+(3.010), (I-746)+(1.007)+(3.011), (I-746)+(1.007)+(3.012), (I-746)+(1.007)+(3.013), (I-746)+(1.007)+(3.014), (I-746)+(1.007)+(3.015), (I-746)+(1.007)+(3.016), (I-746)+(1.007)+(3.017), (I-746)+(1.007)+(3.018), (I-746)+(1.007)+(3.019), (I-746)+(1.007)+(3.020), (I-746)+(1.007)+(3.021), (I-746)+(1.007)+(3.022), (I-746)+(1.007)+(3.023), (I-746)+(1.007)+(3.024), (I-746)+(1.007)+(3.025), (I-746)+(1.007)+(3.026), (I-746)+(1.007)+(3.027), (I-746)+(1.007)+(3.028), (I-746)+(1.007)+(3.029), (I-746)+(1.007)+(3.030), (I-746)+(1.007)+(3.031), (I-746)+(1.007)+(5.001), (I-746)+(1.007)+(5.002), (I-746)+(1.007)+(5.003), (I-746)+(1.007)+(5.004), (I-746)+(1.007)+(5.005), (I-746)+(1.007)+(5.006), (I-746)+(1.007)+(5.007), (I-746)+(1.007)+(5.008), (I-746)+(1.007)+(5.009), (I-746)+(1.007)+(5.010), (I-746)+(1.007)+(5.011), (I-746)+(1.007)+(5.012), (I-746)+(1.007)+(5.013), (I-746)+(1.007)+(5.014), (I-746)+(1.007)+(5.015), (I-746)+(1.007)+(5.016), (I-746)+(1.007)+(5.017), (I-746)+(1.007)+(5.018), (I-746)+(1.007)+(5.019), (I-746)+(1.007)+(5.020), (I-746)+(1.007)+(5.021), (I-746)+(1.007)+(5.022), (I-746)+(1.007)+(5.023), (I-746)+(1.007)+(6.001), (I-746)+(1.007)+(6.002), (I-746)+(1.007)+(6.003), (I-746)+(1.007)+(6.004), (I-746)+(1.007)+(7.001), (I-746)+(1.007)+(7.002), (I-746)+(1.007)+(7.003), (I-746)+(1.007)+(7.004), (I-746)+(1.007)+(7.005), (I-746)+(1.007)+(7.006), (I-746)+(1.007)+(9.001), (I-746)+(1.007)+(9.002), (I-746)+(1.007)+(9.003), (I-746)+(1.007)+(9.004), (I-746)+(1.007)+(9.005), (I-746)+(1.007)+(9.006), (I-746)+(1.007)+(9.007), (I-746)+(1.007)+(9.008), (I-746)+(1.007)+(9.009), (I-746)+(1.007)+(14.001), (I-746)+(1.007)+(14.002), (I-746)+(1.007)+(15.008), (I-746)+(1.007)+(15.011), (I-746)+(1.007)+(15.012), (I-746)+(1.007)+(15.016), (I-746)+(1.007)+(15.025), (I-746)+(1.007)+(15.027), (I-746)+(1.007)+(15.047), (I-746)+(1.007)+(15.063), (I-746)+(1.007)+(15.064), (I-746)+(1.007)+(16.001), (I-746)+(1.007)+(16.002), (I-746)+(1.007)+(16.003), (I-746)+(1.007)+(16.004), (I-746)+(1.007)+(16.005), (I-746)+(1.007)+(16.006), (I-746)+(1.007)+(16.007), (I-746)+(1.007)+(16.008), (I-746)+(1.007)+(17.001), (I-746)+(1.007)+(17.002), (I-746)+(1.007)+(17.003), (I-746)+(1.007)+(17.004), (I-746)+(1.007)+(17.005), (I-746)+(1.007)+(17.006), (I-746)+(1.007)+(17.007), (I-746)+(1.007)+(17.008), (I-746)+(1.007)+(17.009), (I-746)+(1.007)+(17.010), (I-746)+(1.007)+(17.011), (I-746)+(1.007)+(17.012), (I-746)+(1.007)+(18.001),

(I-746)+(1.008)+(1.009), (I-746)+(1.008)+(1.010), (I-746)+(1.008)+(1.011), (I-746)+(1.008)+(1.012), (I-746)+(1.008)+(1.013), (I-746)+(1.008)+(1.014), (I-746)+(1.008)+(1.015), (I-746)+(1.008)+(1.016), (I-746)+(1.008)+(1.017), (I-746)+(1.008)+(1.018), (I-746)+(1.008)+(1.019), (I-746)+(1.008)+(1.020), (I-746)+(1.008)+(1.021), (I-746)+(1.008)+(1.022), (I-746)+(1.008)+(1.023), (I-746)+(1.008)+(1.024), (I-746)+(1.008)+(1.025), (I-746)+(1.008)+(1.026), (I-746)+(1.008)+(1.027), (I-746)+(1.008)+(1.028), (I-746)+(1.008)+(1.029), (I-746)+(1.008)+(1.030), (I-746)+(1.008)+(1.031), (I-746)+(1.008)+(1.032), (I-746)+(1.008)+(1.033), (I-746)+(1.008)+(1.034), (I-746)+(1.008)+(1.035), (I-746)+(1.008)+(1.036), (I-746)+(1.008)+(1.037), (I-746)+(1.008)+(1.038), (I-746)+(1.008)+(1.039), (I-746)+(1.008)+(1.040), (I-746)+(1.008)+(1.041), (I-746)+(1.008)+(1.042), (I-746)+(1.008)+(1.043), (I-746)+(1.008)+(1.044), (I-746)+(1.008)+(1.045), (I-746)+(1.008)+(1.046), (I-746)+(1.008)+(1.047), (I-746)+(1.008)+(1.048), (I-746)+(1.008)+(1.049), (I-746)+(1.008)+(1.050), (I-746)+(1.008)+(1.051), (I-746)+(1.008)+(1.052), (I-746)+(1.008)+(1.053), (I-746)+(1.008)+(1.054), (I-746)+(1.008)+(1.055), (I-746)+(1.008)+(1.056), (I-746)+(1.008)+(1.057), (I-746)+(1.008)+(1.058), (I-746)+(1.008)+(1.059), (I-746)+(1.008)+(1.060), (I-746)+(1.008)+(1.061), (I-746)+(1.008)+(1.062), (I-746)+(1.008)+(1.063), (I-746)+(1.008)+(1.064), (I-746)+(1.008)+(1.065), (I-746)+(1.008)+(1.066), (I-746)+(1.008)+(1.067), (I-746)+(1.008)+(1.068), (I-746)+(1.008)+(1.069), (I-746)+(1.008)+(1.070), (I-746)+(1.008)+(1.071), (I-746)+(1.008)+(1.072), (I-746)+(1.008)+(1.073), (I-746)+(1.008)+(1.074), (I-746)+(1.008)+(1.075), (I-746)+(1.008)+(1.076), (I-746)+(1.008)+(1.077), (I-746)+(1.008)+(1.078), (I-746)+(1.008)+(1.079), (I-746)+(1.008)+(1.080), (I-746)+(1.008)+(1.081), (I-746)+(1.008)+(1.082), (I-746)+(1.008)+(1.083), (I-746)+(1.008)+(1.084), (I-746)+(1.008)+(1.085), (I-746)+(1.008)+(1.086), (I-746)+(1.008)+(1.087), (I-746)+(1.008)+(1.088), (I-746)+(1.008)+(1.089), (I-746)+(1.008)+(1.090), (I-746)+(1.008)+(1.091), (I-746)+(1.008)+(1.092), (I-746)+(1.008)+(2.001), (I-746)+(1.008)+(2.002), (I-746)+(1.008)+(2.003), (I-746)+(1.008)+(2.004), (I-746)+(1.008)+(2.005), (I-746)+(1.008)+(2.006), (I-746)+(1.008)+(2.007), (I-746)+(1.008)+(2.008), (I-746)+(1.008)+(2.009), (I-746)+(1.008)+(2.010), (I-746)+(1.008)+(2.011), (I-746)+(1.008)+(2.012), (I-746)+(1.008)+(2.013), (I-746)+(1.008)+(2.014), (I-746)+(1.008)+(2.015), (I-746)+(1.008)+(2.016), (I-746)+(1.008)+(2.017), (I-746)+(1.008)+(2.018), (I-746)+(1.008)+(2.019), (I-746)+(1.008)+(2.020), (I-746)+(1.008)+(2.021), (I-746)+(1.008)+(2.022), (I-746)+(1.008)+(2.023), (I-746)+(1.008)+(2.024), (I-746)+(1.008)+(2.025), (I-746)+(1.008)+(2.026), (I-746)+(1.008)+(2.027), (I-746)+(1.008)+(2.028), (I-746)+(1.008)+(2.029), (I-746)+(1.008)+(2.030), (I-746)+(1.008)+(2.031), (I-746)+(1.008)+(2.032), (I-746)+(1.008)+(2.033), (I-746)+(1.008)+(2.034), (I-746)+(1.008)+(2.035), (I-746)+(1.008)+(2.036), (I-746)+(1.008)+(2.037), (I-746)+(1.008)+(2.038), (I-746)+(1.008)+(2.039), (I-746)+(1.008)+(2.040), (I-746)+(1.008)+(2.041), (I-746)+(1.008)+(2.042), (I-746)+(1.008)+(2.043), (I-746)+(1.008)+(2.044), (I-746)+(1.008)+(2.045), (I-746)+(1.008)+(2.046), (I-746)+(1.008)+(2.047), (I-746)+(1.008)+(2.048), (I-746)+(1.008)+(2.049), (I-746)+(1.008)+(2.050), (I-746)+(1.008)+(2.051), (I-746)+(1.008)+(2.052), (I-746)+(1.008)+(2.053), (I-746)+(1.008)+(2.054), (I-746)+(1.008)+(2.055), (I-746)+(1.008)+(2.056), (I-746)+(1.008)+(2.057), (I-746)+(1.008)+(2.058), (I-746)+(1.008)+(2.059), (I-746)+(1.008)+(3.001), (I-746)+(1.008)+(3.002), (I-746)+(1.008)+(3.003), (I-746)+(1.008)+(3.004), (I-746)+(1.008)+(3.005), (I-746)+(1.008)+(3.006), (I-746)+(1.008)+(3.007), (I-746)+(1.008)+(3.008), (I-746)+(1.008)+(3.009), (I-746)+(1.008)+(3.010), (I-746)+(1.008)+(3.011), (I-746)+(1.008)+(3.012), (I-746)+(1.008)+(3.013), (I-746)+(1.008)+(3.014), (I-746)+(1.008)+(3.015), (I-746)+(1.008)+(3.016), (I-746)+(1.008)+(3.017), (I-746)+(1.008)+(3.018), (I-746)+(1.008)+(3.019), (I-746)+(1.008)+(3.020), (I-746)+(1.008)+(3.021), (I-746)+(1.008)+(3.022), (I-746)+(1.008)+(3.023), (I-746)+(1.008)+(3.024), (I-746)+(1.008)+(3.025), (I-746)+(1.008)+(3.026), (I-746)+(1.008)+(3.027), (I-746)+(1.008)+(3.028), (I-746)+(1.008)+(3.029), (I-746)+(1.008)+(3.030), (I-746)+(1.008)+(3.031), (I-746)+(1.008)+(5.001), (I-746)+(1.008)+(5.002), (I-746)+(1.008)+(5.003), (I-746)+(1.008)+(5.004), (I-746)+(1.008)+(5.005), (I-746)+(1.008)+(5.006), (I-746)+(1.008)+(5.007), (I-746)+(1.008)+(5.008), (I-746)+(1.008)+(5.009), (I-746)+(1.008)+(5.010), (I-746)+(1.008)+(5.011), (I-746)+(1.008)+(5.012), (I-746)+(1.008)+(5.013), (I-746)+(1.008)+(5.014), (I-746)+(1.008)+(5.015), (I-746)+(1.008)+(5.016), (I-746)+(1.008)+(5.017), (I-746)+(1.008)+(5.018), (I-746)+(1.008)+(5.019), (I-746)+(1.008)+(5.020), (I-746)+(1.008)+(5.021), (I-746)+(1.008)+(5.022), (I-746)+(1.008)+(5.023), (I-746)+(1.008)+(6.001), (I-746)+(1.008)+(6.002), (I-746)+(1.008)+(6.003), (I-746)+(1.008)+(6.004), (I-746)+(1.008)+(7.001), (I-746)+(1.008)+(7.002), (I-746)+(1.008)+(7.003), (I-746)+(1.008)+(7.004), (I-746)+(1.008)+(7.005), (I-746)+(1.008)+(7.006), (I-746)+(1.008)+(9.001), (I-746)+(1.008)+(9.002), (I-746)+(1.008)+(9.003), (I-746)+(1.008)+(9.004), (I-746)+(1.008)+(9.005), (I-746)+(1.008)+(9.006), (I-746)+(1.008)+(9.007), (I-746)+(1.008)+(9.008), (I-746)+(1.008)+(9.009), (I-746)+(1.008)+(14.001), (I-746)+(1.008)+(14.002), (I-746)+(1.008)+(15.008), (I-746)+(1.008)+(15.011), (I-746)+(1.008)+(15.012), (I-746)+(1.008)+(15.016), (I-746)+(1.008)+(15.025), (I-746)+(1.008)+(15.027), (I-746)+(1.008)+(15.047), (I-746)+(1.008)+(15.063), (I-746)+(1.008)+(15.064), (I-746)+(1.008)+(16.001), (I-746)+(1.008)+(16.002), (I-746)+(1.008)+(16.003), (I-746)+(1.008)+(16.004), (I-746)+(1.008)+(16.005), (I-746)+(1.008)+(16.006), (I-746)+(1.008)+(16.007), (I-746)+(1.008)+(16.008), (I-746)+(1.008)+(17.001), (I-746)+(1.008)+(17.002), (I-746)+(1.008)+(17.003), (I-746)+(1.008)+(17.004), (I-746)+(1.008)+(17.005), (I-746)+(1.008)+(17.006), (I-746)+(1.008)+(17.007), (I-746)+(1.008)+(17.008), (I-746)+(1.008)+(17.009), (I-746)+(1.008)+(17.010), (I-746)+(1.008)+(17.011), (I-746)+(1.008)+(17.012), (I-746)+(1.008)+(18.001),

(I-746)+(1.009)+(1.010), (I-746)+(1.009)+(1.011), (I-746)+(1.009)+(1.012), (I-746)+(1.009)+(1.013), (I-746)+(1.009)+(1.014), (I-746)+(1.009)+(1.015), (I-746)+(1.009)+(1.016), (I-746)+(1.009)+(1.017), (I-746)+(1.009)+(1.018), (I-746)+(1.009)+(1.019), (I-746)+(1.009)+(1.020), (I-746)+(1.009)+(1.021), (I-746)+(1.009)+(1.022), (I-746)+(1.009)+(1.023), (I-746)+(1.009)+(1.024), (I-746)+(1.009)+(1.025), (I-746)+(1.009)+(1.026), (I-746)+(1.009)+(1.027), (I-746)+(1.009)+(1.028), (I-746)+(1.009)+(1.029), (I-746)+(1.009)+(1.030), (I-746)+(1.009)+(1.031), (I-746)+(1.009)+(1.032), (I-746)+(1.009)+(1.033), (I-746)+(1.009)+(1.034), (I-746)+(1.009)+(1.035), (I-746)+(1.009)+(1.036), (I-746)+(1.009)+(1.037), (I-746)+(1.009)+(1.038), (I-746)+(1.009)+(1.039), (I-746)+(1.009)+(1.040), (I-746)+(1.009)+(1.041), (I-746)+(1.009)+(1.042), (I-746)+(1.009)+(1.043), (I-746)+(1.009)+(1.044), (I-746)+(1.009)+(1.045), (I-746)+(1.009)+(1.046), (I-746)+(1.009)+(1.047), (I-746)+(1.009)+(1.048), (I-746)+(1.009)+(1.049), (I-746)+(1.009)+(1.050), (I-746)+(1.009)+(1.051), (I-746)+(1.009)+(1.052), (I-746)+(1.009)+(1.053), (I-746)+(1.009)+(1.054), (I-746)+(1.009)+(1.055), (I-746)+(1.009)+(1.056), (I-746)+(1.009)+(1.057), (I-746)+(1.009)+(1.058), (I-746)+(1.009)+(1.059), (I-746)+(1.009)+(1.060), (I-746)+(1.009)+(1.061), (I-746)+(1.009)+(1.062), (I-746)+(1.009)+(1.063), (I-746)+(1.009)+(1.064), (I-746)+(1.009)+(1.065), (I-746)+(1.009)+(1.066), (I-746)+(1.009)+(1.067), (I-746)+(1.009)+(1.068), (I-746)+(1.009)+(1.069), (I-746)+(1.009)+(1.070), (I-746)+(1.009)+(1.071), (I-746)+(1.009)+(1.072), (I-746)+(1.009)+(1.073), (I-746)+(1.009)+(1.074), (I-746)+(1.009)+(1.075), (I-746)+(1.009)+(1.076), (I-746)+(1.009)+(1.077), (I-746)+(1.009)+(1.078), (I-746)+(1.009)+(1.079), (I-746)+(1.009)+(1.080), (I-746)+(1.009)+(1.081), (I-746)+(1.009)+(1.082), (I-746)+(1.009)+(1.083), (I-746)+(1.009)+(1.084), (I-746)+(1.009)+(1.085), (I-746)+(1.009)+(1.086), (I-746)+(1.009)+(1.087), (I-746)+(1.009)+(1.088), (I-746)+(1.009)+(1.089), (I-746)+(1.009)+(1.090), (I-746)+(1.009)+(1.091), (I-746)+(1.009)+(1.092), (I-746)+(1.009)+(2.001), (I-746)+(1.009)+(2.002), (I-746)+(1.009)+(2.003), (I-746)+(1.009)+(2.004), (I-746)+(1.009)+(2.005), (I-746)+(1.009)+(2.006), (I-746)+(1.009)+(2.007), (I-746)+(1.009)+(2.008), (I-746)+(1.009)+(2.009), (I-746)+(1.009)+(2.010), (I-746)+(1.009)+(2.011), (I-746)+(1.009)+(2.012), (I-746)+(1.009)+(2.013), (I-746)+(1.009)+(2.014), (I-746)+(1.009)+(2.015), (I-746)+(1.009)+(2.016), (I-746)+(1.009)+(2.017), (I-746)+(1.009)+(2.018), (I-746)+(1.009)+(2.019), (I-746)+(1.009)+(2.020), (I-746)+(1.009)+(2.021), (I-746)+(1.009)+(2.022), (I-746)+(1.009)+(2.023), (I-746)+(1.009)+(2.024), (I-746)+(1.009)+(2.025), (I-746)+(1.009)+(2.026), (I-746)+(1.009)+(2.027), (I-746)+(1.009)+(2.028), (I-746)+(1.009)+(2.029), (I-746)+(1.009)+(2.030), (I-746)+(1.009)+(2.031), (I-746)+(1.009)+(2.032), (I-746)+(1.009)+(2.033), (I-746)+(1.009)+(2.034), (I-746)+(1.009)+(2.035), (I-746)+(1.009)+(2.036), (I-746)+(1.009)+(2.037), (I-746)+(1.009)+(2.038), (I-746)+(1.009)+(2.039), (I-746)+(1.009)+(2.040), (I-746)+(1.009)+(2.041), (I-746)+(1.009)+(2.042), (I-746)+(1.009)+(2.043), (I-746)+(1.009)+(2.044), (I-746)+(1.009)+(2.045), (I-746)+(1.009)+(2.046), (I-746)+(1.009)+(2.047), (I-746)+(1.009)+(2.048), (I-746)+(1.009)+(2.049), (I-746)+(1.009)+(2.050), (I-746)+(1.009)+(2.051), (I-746)+(1.009)+(2.052), (I-746)+(1.009)+(2.053), (I-746)+(1.009)+(2.054), (I-746)+(1.009)+(2.055), (I-746)+(1.009)+(2.056), (I-746)+(1.009)+(2.057), (I-746)+(1.009)+(2.058), (I-746)+(1.009)+(2.059), (I-746)+(1.009)+(3.001), (I-746)+(1.009)+(3.002), (I-746)+(1.009)+(3.003), (I-746)+(1.009)+(3.004), (I-746)+(1.009)+(3.005), (I-746)+(1.009)+(3.006), (I-746)+(1.009)+(3.007), (I-746)+(1.009)+(3.008), (I-746)+(1.009)+(3.009), (I-746)+(1.009)+(3.010), (I-746)+(1.009)+(3.011), (I-746)+(1.009)+(3.012), (I-746)+(1.009)+(3.013), (I-746)+(1.009)+(3.014), (I-746)+(1.009)+(3.015), (I-746)+(1.009)+(3.016), (I-746)+(1.009)+(3.017), (I-746)+(1.009)+(3.018), (I-746)+(1.009)+(3.019), (I-746)+(1.009)+(3.020), (I-746)+(1.009)+(3.021), (I-746)+(1.009)+(3.022), (I-746)+(1.009)+(3.023), (I-746)+(1.009)+(3.024), (I-746)+(1.009)+(3.025), (I-746)+(1.009)+(3.026), (I-746)+(1.009)+(3.027), (I-746)+(1.009)+(3.028), (I-746)+(1.009)+(3.029), (I-746)+(1.009)+(3.030), (I-746)+(1.009)+(3.031), (I-746)+(1.009)+(5.001), (I-746)+(1.009)+(5.002), (I-746)+(1.009)+(5.003), (I-746)+(1.009)+(5.004), (I-746)+(1.009)+(5.005), (I-746)+(1.009)+(5.006), (I-746)+(1.009)+(5.007), (I-746)+(1.009)+(5.008), (I-746)+(1.009)+(5.009), (I-746)+(1.009)+(5.010), (I-746)+(1.009)+(5.011), (I-746)+(1.009)+(5.012), (I-746)+(1.009)+(5.013), (I-746)+(1.009)+(5.014), (I-746)+(1.009)+(5.015), (I-746)+(1.009)+(5.016), (I-746)+(1.009)+(5.017), (I-746)+(1.009)+(5.018), (I-746)+(1.009)+(5.019), (I-746)+(1.009)+(5.020), (I-746)+(1.009)+(5.021), (I-746)+(1.009)+(5.022), (I-746)+(1.009)+(5.023), (I-746)+(1.009)+(6.001), (I-746)+(1.009)+(6.002), (I-746)+(1.009)+(6.003), (I-746)+(1.009)+(6.004), (I-746)+(1.009)+(7.001), (I-746)+(1.009)+(7.002), (I-746)+(1.009)+(7.003), (I-746)+(1.009)+(7.004), (I-746)+(1.009)+(7.005), (I-746)+(1.009)+(7.006), (I-746)+(1.009)+(9.001), (I-746)+(1.009)+(9.002), (I-746)+(1.009)+(9.003), (I-746)+(1.009)+(9.004), (I-746)+(1.009)+(9.005), (I-746)+(1.009)+(9.006), (I-746)+(1.009)+(9.007), (I-746)+(1.009)+(9.008), (I-746)+(1.009)+(9.009), (I-746)+(1.009)+(14.001), (I-746)+(1.009)+(14.002), (I-746)+(1.009)+(15.008), (I-746)+(1.009)+(15.011), (I-746)+(1.009)+(15.012), (I-746)+(1.009)+(15.016), (I-746)+(1.009)+(15.025), (I-746)+(1.009)+(15.027), (I-746)+(1.009)+(15.047), (I-746)+(1.009)+(15.063), (I-746)+(1.009)+(15.064), (I-746)+(1.009)+(16.001), (I-746)+(1.009)+(16.002), (I-746)+(1.009)+(16.003), (I-746)+(1.009)+(16.004), (I-746)+(1.009)+(16.005), (I-746)+(1.009)+(16.006), (I-746)+(1.009)+(16.007), (I-746)+(1.009)+(16.008), (I-746)+(1.009)+(17.001), (I-746)+(1.009)+(17.002), (I-746)+(1.009)+(17.003), (I-746)+(1.009)+(17.004), (I-746)+(1.009)+(17.005), (I-746)+(1.009)+(17.006), (I-746)+(1.009)+(17.007), (I-746)+(1.009)+(17.008), (I-746)+(1.009)+(17.009), (I-746)+(1.009)+(17.010), (I-746)+(1.009)+(17.011), (I-746)+(1.009)+(17.012), (I-746)+(1.009)+(18.001),

(I-746)+(1.010)+(1.011), (I-746)+(1.010)+(1.012), (I-746)+(1.010)+(1.013), (I-746)+(1.010)+(1.014), (I-746)+(1.010)+(1.015), (I-746)+(1.010)+(1.016), (I-746)+(1.010)+(1.017), (I-746)+(1.010)+(1.018), (I-746)+(1.010)+(1.019), (I-746)+(1.010)+(1.020), (I-746)+(1.010)+(1.021), (I-746)+(1.010)+(1.022), (I-746)+(1.010)+(1.023), (I-746)+(1.010)+(1.024), (I-746)+(1.010)+(1.025), (I-746)+(1.010)+(1.026), (I-746)+(1.010)+(1.027), (I-746)+(1.010)+(1.028), (I-746)+(1.010)+(1.029), (I-746)+(1.010)+(1.030), (I-746)+(1.010)+(1.031), (I-746)+(1.010)+(1.032), (I-746)+(1.010)+(1.033), (I-746)+(1.010)+(1.034), (I-746)+(1.010)+(1.035), (I-746)+(1.010)+(1.036), (I-746)+(1.010)+(1.037), (I-746)+(1.010)+(1.038), (I-746)+(1.010)+(1.039), (I-746)+(1.010)+(1.040), (I-746)+(1.010)+(1.041), (I-746)+(1.010)+(1.042), (I-746)+(1.010)+(1.043), (I-746)+(1.010)+(1.044), (I-746)+(1.010)+(1.045), (I-746)+(1.010)+(1.046), (I-746)+(1.010)+(1.047), (I-746)+(1.010)+(1.048), (I-746)+(1.010)+(1.049), (I-746)+(1.010)+(1.050), (I-746)+(1.010)+(1.051), (I-746)+(1.010)+(1.052), (I-746)+(1.010)+(1.053), (I-746)+(1.010)+(1.054), (I-746)+(1.010)+(1.055), (I-746)+(1.010)+(1.056), (I-746)+(1.010)+(1.057), (I-746)+(1.010)+(1.058), (I-746)+(1.010)+(1.059), (I-746)+(1.010)+(1.060), (I-746)+(1.010)+(1.061), (I-746)+(1.010)+(1.062), (I-746)+(1.010)+(1.063), (I-746)+(1.010)+(1.064), (I-746)+(1.010)+(1.065), (I-746)+(1.010)+(1.066), (I-746)+(1.010)+(1.067), (I-746)+(1.010)+(1.068), (I-746)+(1.010)+(1.069), (I-746)+(1.010)+(1.070), (I-746)+(1.010)+(1.071), (I-746)+(1.010)+(1.072), (I-746)+(1.010)+(1.073), (I-746)+(1.010)+(1.074), (I-746)+(1.010)+(1.075), (I-746)+(1.010)+(1.076), (I-746)+(1.010)+(1.077), (I-746)+(1.010)+(1.078), (I-746)+(1.010)+(1.079), (I-746)+(1.010)+(1.080), (I-746)+(1.010)+(1.081), (I-746)+(1.010)+(1.082), (I-746)+(1.010)+(1.083), (I-746)+(1.010)+(1.084), (I-746)+(1.010)+(1.085), (I-746)+(1.010)+(1.086), (I-746)+(1.010)+(1.087), (I-746)+(1.010)+(1.088), (I-746)+(1.010)+(1.089), (I-746)+(1.010)+(1.090), (I-746)+(1.010)+(1.091), (I-746)+(1.010)+(1.092), (I-746)+(1.010)+(2.001), (I-746)+(1.010)+(2.002), (I-746)+(1.010)+(2.003), (I-746)+(1.010)+(2.004), (I-746)+(1.010)+(2.005), (I-746)+(1.010)+(2.006), (I-746)+(1.010)+(2.007), (I-746)+(1.010)+(2.008), (I-746)+(1.010)+(2.009), (I-746)+(1.010)+(2.010), (I-746)+(1.010)+(2.011), (I-746)+(1.010)+(2.012), (I-746)+(1.010)+(2.013), (I-746)+(1.010)+(2.014), (I-746)+(1.010)+(2.015), (I-746)+(1.010)+(2.016), (I-746)+(1.010)+(2.017), (I-746)+(1.010)+(2.018), (I-746)+(1.010)+(2.019), (I-746)+(1.010)+(2.020), (I-746)+(1.010)+(2.021), (I-746)+(1.010)+(2.022), (I-746)+(1.010)+(2.023), (I-746)+(1.010)+(2.024), (I-746)+(1.010)+(2.025), (I-746)+(1.010)+(2.026), (I-746)+(1.010)+(2.027), (I-746)+(1.010)+(2.028), (I-746)+(1.010)+(2.029), (I-746)+(1.010)+(2.030), (I-746)+(1.010)+(2.031), (I-746)+(1.010)+(2.032), (I-746)+(1.010)+(2.033), (I-746)+(1.010)+(2.034), (I-746)+(1.010)+(2.035), (I-746)+(1.010)+(2.036), (I-746)+(1.010)+(2.037), (I-746)+(1.010)+(2.038), (I-746)+(1.010)+(2.039), (I-746)+(1.010)+(2.040), (I-746)+(1.010)+(2.041), (I-746)+(1.010)+(2.042), (I-746)+(1.010)+(2.043), (I-746)+(1.010)+(2.044), (I-746)+(1.010)+(2.045), (I-746)+(1.010)+(2.046), (I-746)+(1.010)+(2.047), (I-746)+(1.010)+(2.048), (I-746)+(1.010)+(2.049), (I-746)+(1.010)+(2.050), (I-746)+(1.010)+(2.051), (I-746)+(1.010)+(2.052), (I-746)+(1.010)+(2.053), (I-746)+(1.010)+(2.054), (I-746)+(1.010)+(2.055), (I-746)+(1.010)+(2.056), (I-746)+(1.010)+(2.057), (I-746)+(1.010)+(2.058), (I-746)+(1.010)+(2.059), (I-746)+(1.010)+(3.001), (I-746)+(1.010)+(3.002), (I-746)+(1.010)+(3.003), (I-746)+(1.010)+(3.004), (I-746)+(1.010)+(3.005), (I-746)+(1.010)+(3.006), (I-746)+(1.010)+(3.007), (I-746)+(1.010)+(3.008), (I-746)+(1.010)+(3.009), (I-746)+(1.010)+(3.010), (I-746)+(1.010)+(3.011), (I-746)+(1.010)+(3.012), (I-746)+(1.010)+(3.013), (I-746)+(1.010)+(3.014), (I-746)+(1.010)+(3.015), (I-746)+(1.010)+(3.016), (I-746)+(1.010)+(3.017), (I-746)+(1.010)+(3.018), (I-746)+(1.010)+(3.019), (I-746)+(1.010)+(3.020), (I-746)+(1.010)+(3.021), (I-746)+(1.010)+(3.022), (I-746)+(1.010)+(3.023), (I-746)+(1.010)+(3.024), (I-746)+(1.010)+(3.025), (I-746)+(1.010)+(3.026), (I-746)+(1.010)+(3.027), (I-746)+(1.010)+(3.028), (I-746)+(1.010)+(3.029), (I-746)+(1.010)+(3.030), (I-746)+(1.010)+(3.031), (I-746)+(1.010)+(5.001), (I-746)+(1.010)+(5.002), (I-746)+(1.010)+(5.003), (I-746)+(1.010)+(5.004), (I-746)+(1.010)+(5.005), (I-746)+(1.010)+(5.006), (I-746)+(1.010)+(5.007), (I-746)+(1.010)+(5.008), (I-746)+(1.010)+(5.009), (I-746)+(1.010)+(5.010), (I-746)+(1.010)+(5.011), (I-746)+(1.010)+(5.012), (I-746)+(1.010)+(5.013), (I-746)+(1.010)+(5.014), (I-746)+(1.010)+(5.015), (I-746)+(1.010)+(5.016), (I-746)+(1.010)+(5.017), (I-746)+(1.010)+(5.018), (I-746)+(1.010)+(5.019), (I-746)+(1.010)+(5.020), (I-746)+(1.010)+(5.021), (I-746)+(1.010)+(5.022), (I-746)+(1.010)+(5.023), (I-746)+(1.010)+(6.001), (I-746)+(1.010)+(6.002), (I-746)+(1.010)+(6.003), (I-746)+(1.010)+(6.004), (I-746)+(1.010)+(7.001), (I-746)+(1.010)+(7.002), (I-746)+(1.010)+(7.003), (I-746)+(1.010)+(7.004), (I-746)+(1.010)+(7.005), (I-746)+(1.010)+(7.006), (I-746)+(1.010)+(9.001), (I-746)+(1.010)+(9.002), (I-746)+(1.010)+(9.003), (I-746)+(1.010)+(9.004), (I-746)+(1.010)+(9.005), (I-746)+(1.010)+(9.006), (I-746)+(1.010)+(9.007), (I-746)+(1.010)+(9.008), (I-746)+(1.010)+(9.009), (I-746)+(1.010)+(14.001), (I-746)+(1.010)+(14.002), (I-746)+(1.010)+(15.008), (I-746)+(1.010)+(15.011), (I-746)+(1.010)+(15.012), (I-746)+(1.010)+(15.016), (I-746)+(1.010)+(15.025), (I-746)+(1.010)+(15.027), (I-746)+(1.010)+(15.047), (I-746)+(1.010)+(15.063), (I-746)+(1.010)+(15.064), (I-746)+(1.010)+(16.001), (I-746)+(1.010)+(16.002), (I-746)+(1.010)+(16.003), (I-746)+(1.010)+(16.004), (I-746)+(1.010)+(16.005), (I-746)+(1.010)+(16.006), (I-746)+(1.010)+(16.007), (I-746)+(1.010)+(16.008), (I-746)+(1.010)+(17.001), (I-746)+(1.010)+(17.002), (I-746)+(1.010)+(17.003), (I-746)+(1.010)+(17.004), (I-746)+(1.010)+(17.005), (I-746)+(1.010)+(17.006), (I-746)+(1.010)+(17.007), (I-746)+(1.010)+(17.008), (I-746)+(1.010)+(17.009), (I-746)+(1.010)+(17.010), (I-746)+(1.010)+(17.011), (I-746)+(1.010)+(17.012), (I-746)+(1.010)+(18.001),

(I-746)+(1.011)+(1.012), (I-746)+(1.011)+(1.013), (I-746)+(1.011)+(1.014), (I-746)+(1.011)+(1.015), (I-746)+(1.011)+(1.016), (I-746)+(1.011)+(1.017), (I-746)+(1.011)+(1.018), (I-746)+(1.011)+(1.019), (I-746)+(1.011)+(1.020), (I-746)+(1.011)+(1.021), (I-746)+(1.011)+(1.022), (I-746)+(1.011)+(1.023), (I-746)+(1.011)+(1.024), (I-746)+(1.011)+(1.025), (I-746)+(1.011)+(1.026), (I-746)+(1.011)+(1.027), (I-746)+(1.011)+(1.028), (I-746)+(1.011)+(1.029), (I-746)+(1.011)+(1.030), (I-746)+(1.011)+(1.031), (I-746)+(1.011)+(1.032), (I-746)+(1.011)+(1.033), (I-746)+(1.011)+(1.034), (I-746)+(1.011)+(1.035), (I-746)+(1.011)+(1.036), (I-746)+(1.011)+(1.037), (I-746)+(1.011)+(1.038), (I-746)+(1.011)+(1.039), (I-746)+(1.011)+(1.040), (I-746)+(1.011)+(1.041), (I-746)+(1.011)+(1.042), (I-746)+(1.011)+(1.043), (I-746)+(1.011)+(1.044), (I-746)+(1.011)+(1.045), (I-746)+(1.011)+(1.046), (I-746)+(1.011)+(1.047), (I-746)+(1.011)+(1.048), (I-746)+(1.011)+(1.049), (I-746)+(1.011)+(1.050), (I-746)+(1.011)+(1.051), (I-746)+(1.011)+(1.052), (I-746)+(1.011)+(1.053), (I-746)+(1.011)+(1.054), (I-746)+(1.011)+(1.055), (I-746)+(1.011)+(1.056), (I-746)+(1.011)+(1.057), (I-746)+(1.011)+(1.058), (I-746)+(1.011)+(1.059), (I-746)+(1.011)+(1.060), (I-746)+(1.011)+(1.061), (I-746)+(1.011)+(1.062), (I-746)+(1.011)+(1.063), (I-746)+(1.011)+(1.064), (I-746)+(1.011)+(1.065), (I-746)+(1.011)+(1.066), (I-746)+(1.011)+(1.067), (I-746)+(1.011)+(1.068), (I-746)+(1.011)+(1.069), (I-746)+(1.011)+(1.070), (I-746)+(1.011)+(1.071), (I-746)+(1.011)+(1.072), (I-746)+(1.011)+(1.073), (I-746)+(1.011)+(1.074), (I-746)+(1.011)+(1.075), (I-746)+(1.011)+(1.076), (I-746)+(1.011)+(1.077), (I-746)+(1.011)+(1.078), (I-746)+(1.011)+(1.079), (I-746)+(1.011)+(1.080), (I-746)+(1.011)+(1.081), (I-746)+(1.011)+(1.082), (I-746)+(1.011)+(1.083), (I-746)+(1.011)+(1.084), (I-746)+(1.011)+(1.085), (I-746)+(1.011)+(1.086), (I-746)+(1.011)+(1.087), (I-746)+(1.011)+(1.088), (I-746)+(1.011)+(1.089), (I-746)+(1.011)+(1.090), (I-746)+(1.011)+(1.091), (I-746)+(1.011)+(1.092), (I-746)+(1.011)+(2.001), (I-746)+(1.011)+(2.002), (I-746)+(1.011)+(2.003), (I-746)+(1.011)+(2.004), (I-746)+(1.011)+(2.005), (I-746)+(1.011)+(2.006), (I-746)+(1.011)+(2.007), (I-746)+(1.011)+(2.008), (I-746)+(1.011)+(2.009), (I-746)+(1.011)+(2.010), (I-746)+(1.011)+(2.011), (I-746)+(1.011)+(2.012), (I-746)+(1.011)+(2.013), (I-746)+(1.011)+(2.014), (I-746)+(1.011)+(2.015), (I-746)+(1.011)+(2.016), (I-746)+(1.011)+(2.017), (I-746)+(1.011)+(2.018), (I-746)+(1.011)+(2.019), (I-746)+(1.011)+(2.020), (I-746)+(1.011)+(2.021), (I-746)+(1.011)+(2.022), (I-746)+(1.011)+(2.023), (I-746)+(1.011)+(2.024), (I-746)+(1.011)+(2.025), (I-746)+(1.011)+(2.026), (I-746)+(1.011)+(2.027), (I-746)+(1.011)+(2.028), (I-746)+(1.011)+(2.029), (I-746)+(1.011)+(2.030), (I-746)+(1.011)+(2.031), (I-746)+(1.011)+(2.032), (I-746)+(1.011)+(2.033), (I-746)+(1.011)+(2.034), (I-746)+(1.011)+(2.035), (I-746)+(1.011)+(2.036), (I-746)+(1.011)+(2.037), (I-746)+(1.011)+(2.038), (I-746)+(1.011)+(2.039), (I-746)+(1.011)+(2.040), (I-746)+(1.011)+(2.041), (I-746)+(1.011)+(2.042), (I-746)+(1.011)+(2.043), (I-746)+(1.011)+(2.044), (I-746)+(1.011)+(2.045), (I-746)+(1.011)+(2.046), (I-746)+(1.011)+(2.047), (I-746)+(1.011)+(2.048), (I-746)+(1.011)+(2.049), (I-746)+(1.011)+(2.050), (I-746)+(1.011)+(2.051), (I-746)+(1.011)+(2.052), (I-746)+(1.011)+(2.053), (I-746)+(1.011)+(2.054), (I-746)+(1.011)+(2.055), (I-746)+(1.011)+(2.056), (I-746)+(1.011)+(2.057), (I-746)+(1.011)+(2.058), (I-746)+(1.011)+(2.059), (I-746)+(1.011)+(3.001), (I-746)+(1.011)+(3.002), (I-746)+(1.011)+(3.003), (I-746)+(1.011)+(3.004), (I-746)+(1.011)+(3.005), (I-746)+(1.011)+(3.006), (I-746)+(1.011)+(3.007), (I-746)+(1.011)+(3.008), (I-746)+(1.011)+(3.009), (I-746)+(1.011)+(3.010), (I-746)+(1.011)+(3.011), (I-746)+(1.011)+(3.012), (I-746)+(1.011)+(3.013), (I-746)+(1.011)+(3.014), (I-746)+(1.011)+(3.015), (I-746)+(1.011)+(3.016), (I-746)+(1.011)+(3.017), (I-746)+(1.011)+(3.018), (I-746)+(1.011)+(3.019), (I-746)+(1.011)+(3.020), (I-746)+(1.011)+(3.021), (I-746)+(1.011)+(3.022), (I-746)+(1.011)+(3.023), (I-746)+(1.011)+(3.024), (I-746)+(1.011)+(3.025), (I-746)+(1.011)+(3.026), (I-746)+(1.011)+(3.027), (I-746)+(1.011)+(3.028), (I-746)+(1.011)+(3.029), (I-746)+(1.011)+(3.030), (I-746)+(1.011)+(3.031), (I-746)+(1.011)+(5.001), (I-746)+(1.011)+(5.002), (I-746)+(1.011)+(5.003), (I-746)+(1.011)+(5.004), (I-746)+(1.011)+(5.005), (I-746)+(1.011)+(5.006), (I-746)+(1.011)+(5.007), (I-746)+(1.011)+(5.008), (I-746)+(1.011)+(5.009), (I-746)+(1.011)+(5.010), (I-746)+(1.011)+(5.011), (I-746)+(1.011)+(5.012), (I-746)+(1.011)+(5.013), (I-746)+(1.011)+(5.014), (I-746)+(1.011)+(5.015), (I-746)+(1.011)+(5.016), (I-746)+(1.011)+(5.017), (I-746)+(1.011)+(5.018), (I-746)+(1.011)+(5.019), (I-746)+(1.011)+(5.020), (I-746)+(1.011)+(5.021), (I-746)+(1.011)+(5.022), (I-746)+(1.011)+(5.023), (I-746)+(1.011)+(6.001), (I-746)+(1.011)+(6.002), (I-746)+(1.011)+(6.003), (I-746)+(1.011)+(6.004), (I-746)+(1.011)+(7.001), (I-746)+(1.011)+(7.002), (I-746)+(1.011)+(7.003), (I-746)+(1.011)+(7.004), (I-746)+(1.011)+(7.005), (I-746)+(1.011)+(7.006), (I-746)+(1.011)+(9.001), (I-746)+(1.011)+(9.002), (I-746)+(1.011)+(9.003), (I-746)+(1.011)+(9.004), (I-746)+(1.011)+(9.005), (I-746)+(1.011)+(9.006), (I-746)+(1.011)+(9.007), (I-746)+(1.011)+(9.008), (I-746)+(1.011)+(9.009), (I-746)+(1.011)+(14.001), (I-746)+(1.011)+(14.002), (I-746)+(1.011)+(15.008), (I-746)+(1.011)+(15.011), (I-746)+(1.011)+(15.012), (I-746)+(1.011)+(15.016), (I-746)+(1.011)+(15.025), (I-746)+(1.011)+(15.027), (I-746)+(1.011)+(15.047), (I-746)+(1.011)+(15.063), (I-746)+(1.011)+(15.064), (I-746)+(1.011)+(16.001), (I-746)+(1.011)+(16.002), (I-746)+(1.011)+(16.003), (I-746)+(1.011)+(16.004), (I-746)+(1.011)+(16.005), (I-746)+(1.011)+(16.006), (I-746)+(1.011)+(16.007), (I-746)+(1.011)+(16.008), (I-746)+(1.011)+(17.001), (I-746)+(1.011)+(17.002), (I-746)+(1.011)+(17.003), (I-746)+(1.011)+(17.004), (I-746)+(1.011)+(17.005), (I-746)+(1.011)+(17.006), (I-746)+(1.011)+(17.007), (I-746)+(1.011)+(17.008), (I-746)+(1.011)+(17.009), (I-746)+(1.011)+(17.010), (I-746)+(1.011)+(17.011), (I-746)+(1.011)+(17.012), (I-746)+(1.011)+(18.001),

(I-746)+(1.012)+(1.013), (I-746)+(1.012)+(1.014), (I-746)+(1.012)+(1.015), (I-746)+(1.012)+(1.016), (I-746)+(1.012)+(1.017), (I-746)+(1.012)+(1.018), (I-746)+(1.012)+(1.019), (I-746)+(1.012)+(1.020), (I-746)+(1.012)+(1.021), (I-746)+(1.012)+(1.022), (I-746)+(1.012)+(1.023), (I-746)+(1.012)+(1.024), (I-746)+(1.012)+(1.025), (I-746)+(1.012)+(1.026), (I-746)+(1.012)+(1.027), (I-746)+(1.012)+(1.028), (I-746)+(1.012)+(1.029), (I-746)+(1.012)+(1.030), (I-746)+(1.012)+(1.031), (I-746)+(1.012)+(1.032), (I-746)+(1.012)+(1.033), (I-746)+(1.012)+(1.034), (I-746)+(1.012)+(1.035), (I-746)+(1.012)+(1.036), (I-746)+(1.012)+(1.037), (I-746)+(1.012)+(1.038), (I-746)+(1.012)+(1.039), (I-746)+(1.012)+(1.040), (I-746)+(1.012)+(1.041), (I-746)+(1.012)+(1.042), (I-746)+(1.012)+(1.043), (I-746)+(1.012)+(1.044), (I-746)+(1.012)+(1.045), (I-746)+(1.012)+(1.046), (I-746)+(1.012)+(1.047), (I-746)+(1.012)+(1.048), (I-746)+(1.012)+(1.049), (I-746)+(1.012)+(1.050), (I-746)+(1.012)+(1.051), (I-746)+(1.012)+(1.052), (I-746)+(1.012)+(1.053), (I-746)+(1.012)+(1.054), (I-746)+(1.012)+(1.055), (I-746)+(1.012)+(1.056), (I-746)+(1.012)+(1.057), (I-746)+(1.012)+(1.058), (I-746)+(1.012)+(1.059), (I-746)+(1.012)+(1.060), (I-746)+(1.012)+(1.061), (I-746)+(1.012)+(1.062), (I-746)+(1.012)+(1.063), (I-746)+(1.012)+(1.064), (I-746)+(1.012)+(1.065), (I-746)+(1.012)+(1.066), (I-746)+(1.012)+(1.067), (I-746)+(1.012)+(1.068), (I-746)+(1.012)+(1.069), (I-746)+(1.012)+(1.070), (I-746)+(1.012)+(1.071), (I-746)+(1.012)+(1.072), (I-746)+(1.012)+(1.073), (I-746)+(1.012)+(1.074), (I-746)+(1.012)+(1.075), (I-746)+(1.012)+(1.076), (I-746)+(1.012)+(1.077), (I-746)+(1.012)+(1.078), (I-746)+(1.012)+(1.079), (I-746)+(1.012)+(1.080), (I-746)+(1.012)+(1.081), (I-746)+(1.012)+(1.082), (I-746)+(1.012)+(1.083), (I-746)+(1.012)+(1.084), (I-746)+(1.012)+(1.085), (I-746)+(1.012)+(1.086), (I-746)+(1.012)+(1.087), (I-746)+(1.012)+(1.088), (I-746)+(1.012)+(1.089), (I-746)+(1.012)+(1.090), (I-746)+(1.012)+(1.091), (I-746)+(1.012)+(1.092), (I-746)+(1.012)+(2.001), (I-746)+(1.012)+(2.002), (I-746)+(1.012)+(2.003), (I-746)+(1.012)+(2.004), (I-746)+(1.012)+(2.005), (I-746)+(1.012)+(2.006), (I-746)+(1.012)+(2.007), (I-746)+(1.012)+(2.008), (I-746)+(1.012)+(2.009), (I-746)+(1.012)+(2.010), (I-746)+(1.012)+(2.011), (I-746)+(1.012)+(2.012), (I-746)+(1.012)+(2.013), (I-746)+(1.012)+(2.014), (I-746)+(1.012)+(2.015), (I-746)+(1.012)+(2.016), (I-746)+(1.012)+(2.017), (I-746)+(1.012)+(2.018), (I-746)+(1.012)+(2.019), (I-746)+(1.012)+(2.020), (I-746)+(1.012)+(2.021), (I-746)+(1.012)+(2.022), (I-746)+(1.012)+(2.023), (I-746)+(1.012)+(2.024), (I-746)+(1.012)+(2.025), (I-746)+(1.012)+(2.026), (I-746)+(1.012)+(2.027), (I-746)+(1.012)+(2.028), (I-746)+(1.012)+(2.029), (I-746)+(1.012)+(2.030), (I-746)+(1.012)+(2.031), (I-746)+(1.012)+(2.032), (I-746)+(1.012)+(2.033), (I-746)+(1.012)+(2.034), (I-746)+(1.012)+(2.035), (I-746)+(1.012)+(2.036), (I-746)+(1.012)+(2.037), (I-746)+(1.012)+(2.038), (I-746)+(1.012)+(2.039), (I-746)+(1.012)+(2.040), (I-746)+(1.012)+(2.041), (I-746)+(1.012)+(2.042), (I-746)+(1.012)+(2.043), (I-746)+(1.012)+(2.044), (I-746)+(1.012)+(2.045), (I-746)+(1.012)+(2.046), (I-746)+(1.012)+(2.047), (I-746)+(1.012)+(2.048), (I-746)+(1.012)+(2.049), (I-746)+(1.012)+(2.050), (I-746)+(1.012)+(2.051), (I-746)+(1.012)+(2.052), (I-746)+(1.012)+(2.053), (I-746)+(1.012)+(2.054), (I-746)+(1.012)+(2.055), (I-746)+(1.012)+(2.056), (I-746)+(1.012)+(2.057), (I-746)+(1.012)+(2.058), (I-746)+(1.012)+(2.059), (I-746)+(1.012)+(3.001), (I-746)+(1.012)+(3.002), (I-746)+(1.012)+(3.003), (I-746)+(1.012)+(3.004), (I-746)+(1.012)+(3.005), (I-746)+(1.012)+(3.006), (I-746)+(1.012)+(3.007), (I-746)+(1.012)+(3.008), (I-746)+(1.012)+(3.009), (I-746)+(1.012)+(3.010), (I-746)+(1.012)+(3.011), (I-746)+(1.012)+(3.012), (I-746)+(1.012)+(3.013), (I-746)+(1.012)+(3.014), (I-746)+(1.012)+(3.015), (I-746)+(1.012)+(3.016), (I-746)+(1.012)+(3.017), (I-746)+(1.012)+(3.018), (I-746)+(1.012)+(3.019), (I-746)+(1.012)+(3.020), (I-746)+(1.012)+(3.021), (I-746)+(1.012)+(3.022), (I-746)+(1.012)+(3.023), (I-746)+(1.012)+(3.024), (I-746)+(1.012)+(3.025), (I-746)+(1.012)+(3.026), (I-746)+(1.012)+(3.027), (I-746)+(1.012)+(3.028), (I-746)+(1.012)+(3.029), (I-746)+(1.012)+(3.030), (I-746)+(1.012)+(3.031), (I-746)+(1.012)+(5.001), (I-746)+(1.012)+(5.002), (I-746)+(1.012)+(5.003), (I-746)+(1.012)+(5.004), (I-746)+(1.012)+(5.005), (I-746)+(1.012)+(5.006), (I-746)+(1.012)+(5.007), (I-746)+(1.012)+(5.008), (I-746)+(1.012)+(5.009), (I-746)+(1.012)+(5.010), (I-746)+(1.012)+(5.011), (I-746)+(1.012)+(5.012), (I-746)+(1.012)+(5.013), (I-746)+(1.012)+(5.014), (I-746)+(1.012)+(5.015), (I-746)+(1.012)+(5.016), (I-746)+(1.012)+(5.017), (I-746)+(1.012)+(5.018), (I-746)+(1.012)+(5.019), (I-746)+(1.012)+(5.020), (I-746)+(1.012)+(5.021), (I-746)+(1.012)+(5.022), (I-746)+(1.012)+(5.023), (I-746)+(1.012)+(6.001), (I-746)+(1.012)+(6.002), (I-746)+(1.012)+(6.003), (I-746)+(1.012)+(6.004), (I-746)+(1.012)+(7.001), (I-746)+(1.012)+(7.002), (I-746)+(1.012)+(7.003), (I-746)+(1.012)+(7.004), (I-746)+(1.012)+(7.005), (I-746)+(1.012)+(7.006), (I-746)+(1.012)+(9.001), (I-746)+(1.012)+(9.002), (I-746)+(1.012)+(9.003), (I-746)+(1.012)+(9.004), (I-746)+(1.012)+(9.005), (I-746)+(1.012)+(9.006), (I-746)+(1.012)+(9.007), (I-746)+(1.012)+(9.008), (I-746)+(1.012)+(9.009), (I-746)+(1.012)+(14.001), (I-746)+(1.012)+(14.002), (I-746)+(1.012)+(15.008), (I-746)+(1.012)+(15.011), (I-746)+(1.012)+(15.012), (I-746)+(1.012)+(15.016), (I-746)+(1.012)+(15.025), (I-746)+(1.012)+(15.027), (I-746)+(1.012)+(15.047), (I-746)+(1.012)+(15.063), (I-746)+(1.012)+(15.064), (I-746)+(1.012)+(16.001), (I-746)+(1.012)+(16.002), (I-746)+(1.012)+(16.003), (I-746)+(1.012)+(16.004), (I-746)+(1.012)+(16.005), (I-746)+(1.012)+(16.006), (I-746)+(1.012)+(16.007), (I-746)+(1.012)+(16.008), (I-746)+(1.012)+(17.001), (I-746)+(1.012)+(17.002), (I-746)+(1.012)+(17.003), (I-746)+(1.012)+(17.004), (I-746)+(1.012)+(17.005), (I-746)+(1.012)+(17.006), (I-746)+(1.012)+(17.007), (I-746)+(1.012)+(17.008), (I-746)+(1.012)+(17.009), (I-746)+(1.012)+(17.010), (I-746)+(1.012)+(17.011), (I-746)+(1.012)+(17.012), (I-746)+(1.012)+(18.001),

(I-746)+(1.013)+(1.014), (I-746)+(1.013)+(1.015), (I-746)+(1.013)+(1.016), (I-746)+(1.013)+(1.017), (I-746)+(1.013)+(1.018), (I-746)+(1.013)+(1.019), (I-746)+(1.013)+(1.020), (I-746)+(1.013)+(1.021), (I-746)+(1.013)+(1.022), (I-746)+(1.013)+(1.023), (I-746)+(1.013)+(1.024), (I-746)+(1.013)+(1.025), (I-746)+(1.013)+(1.026), (I-746)+(1.013)+(1.027), (I-746)+(1.013)+(1.028), (I-746)+(1.013)+(1.029), (I-746)+(1.013)+(1.030), (I-746)+(1.013)+(1.031), (I-746)+(1.013)+(1.032), (I-746)+(1.013)+(1.033), (I-746)+(1.013)+(1.034), (I-746)+(1.013)+(1.035), (I-746)+(1.013)+(1.036), (I-746)+(1.013)+(1.037), (I-746)+(1.013)+(1.038), (I-746)+(1.013)+(1.039), (I-746)+(1.013)+(1.040), (I-746)+(1.013)+(1.041), (I-746)+(1.013)+(1.042), (I-746)+(1.013)+(1.043), (I-746)+(1.013)+(1.044), (I-746)+(1.013)+(1.045), (I-746)+(1.013)+(1.046), (I-746)+(1.013)+(1.047), (I-746)+(1.013)+(1.048), (I-746)+(1.013)+(1.049), (I-746)+(1.013)+(1.050), (I-746)+(1.013)+(1.051), (I-746)+(1.013)+(1.052), (I-746)+(1.013)+(1.053), (I-746)+(1.013)+(1.054), (I-746)+(1.013)+(1.055), (I-746)+(1.013)+(1.056), (I-746)+(1.013)+(1.057), (I-746)+(1.013)+(1.058), (I-746)+(1.013)+(1.059), (I-746)+(1.013)+(1.060), (I-746)+(1.013)+(1.061), (I-746)+(1.013)+(1.062), (I-746)+(1.013)+(1.063), (I-746)+(1.013)+(1.064), (I-746)+(1.013)+(1.065), (I-746)+(1.013)+(1.066), (I-746)+(1.013)+(1.067), (I-746)+(1.013)+(1.068), (I-746)+(1.013)+(1.069), (I-746)+(1.013)+(1.070), (I-746)+(1.013)+(1.071), (I-746)+(1.013)+(1.072), (I-746)+(1.013)+(1.073), (I-746)+(1.013)+(1.074), (I-746)+(1.013)+(1.075), (I-746)+(1.013)+(1.076), (I-746)+(1.013)+(1.077), (I-746)+(1.013)+(1.078), (I-746)+(1.013)+(1.079), (I-746)+(1.013)+(1.080), (I-746)+(1.013)+(1.081), (I-746)+(1.013)+(1.082), (I-746)+(1.013)+(1.083), (I-746)+(1.013)+(1.084), (I-746)+(1.013)+(1.085), (I-746)+(1.013)+(1.086), (I-746)+(1.013)+(1.087), (I-746)+(1.013)+(1.088), (I-746)+(1.013)+(1.089), (I-746)+(1.013)+(1.090), (I-746)+(1.013)+(1.091), (I-746)+(1.013)+(1.092), (I-746)+(1.013)+(2.001), (I-746)+(1.013)+(2.002), (I-746)+(1.013)+(2.003), (I-746)+(1.013)+(2.004), (I-746)+(1.013)+(2.005), (I-746)+(1.013)+(2.006), (I-746)+(1.013)+(2.007), (I-746)+(1.013)+(2.008), (I-746)+(1.013)+(2.009), (I-746)+(1.013)+(2.010), (I-746)+(1.013)+(2.011), (I-746)+(1.013)+(2.012), (I-746)+(1.013)+(2.013), (I-746)+(1.013)+(2.014), (I-746)+(1.013)+(2.015), (I-746)+(1.013)+(2.016), (I-746)+(1.013)+(2.017), (I-746)+(1.013)+(2.018), (I-746)+(1.013)+(2.019), (I-746)+(1.013)+(2.020), (I-746)+(1.013)+(2.021), (I-746)+(1.013)+(2.022), (I-746)+(1.013)+(2.023), (I-746)+(1.013)+(2.024), (I-746)+(1.013)+(2.025), (I-746)+(1.013)+(2.026), (I-746)+(1.013)+(2.027), (I-746)+(1.013)+(2.028), (I-746)+(1.013)+(2.029), (I-746)+(1.013)+(2.030), (I-746)+(1.013)+(2.031), (I-746)+(1.013)+(2.032), (I-746)+(1.013)+(2.033), (I-746)+(1.013)+(2.034), (I-746)+(1.013)+(2.035), (I-746)+(1.013)+(2.036), (I-746)+(1.013)+(2.037), (I-746)+(1.013)+(2.038), (I-746)+(1.013)+(2.039), (I-746)+(1.013)+(2.040), (I-746)+(1.013)+(2.041), (I-746)+(1.013)+(2.042), (I-746)+(1.013)+(2.043), (I-746)+(1.013)+(2.044), (I-746)+(1.013)+(2.045), (I-746)+(1.013)+(2.046), (I-746)+(1.013)+(2.047), (I-746)+(1.013)+(2.048), (I-746)+(1.013)+(2.049), (I-746)+(1.013)+(2.050), (I-746)+(1.013)+(2.051), (I-746)+(1.013)+(2.052), (I-746)+(1.013)+(2.053), (I-746)+(1.013)+(2.054), (I-746)+(1.013)+(2.055), (I-746)+(1.013)+(2.056), (I-746)+(1.013)+(2.057), (I-746)+(1.013)+(2.058), (I-746)+(1.013)+(2.059), (I-746)+(1.013)+(3.001), (I-746)+(1.013)+(3.002), (I-746)+(1.013)+(3.003), (I-746)+(1.013)+(3.004), (I-746)+(1.013)+(3.005), (I-746)+(1.013)+(3.006), (I-746)+(1.013)+(3.007), (I-746)+(1.013)+(3.008), (I-746)+(1.013)+(3.009), (I-746)+(1.013)+(3.010), (I-746)+(1.013)+(3.011), (I-746)+(1.013)+(3.012), (I-746)+(1.013)+(3.013), (I-746)+(1.013)+(3.014), (I-746)+(1.013)+(3.015), (I-746)+(1.013)+(3.016), (I-746)+(1.013)+(3.017), (I-746)+(1.013)+(3.018), (I-746)+(1.013)+(3.019), (I-746)+(1.013)+(3.020), (I-746)+(1.013)+(3.021), (I-746)+(1.013)+(3.022), (I-746)+(1.013)+(3.023), (I-746)+(1.013)+(3.024), (I-746)+(1.013)+(3.025), (I-746)+(1.013)+(3.026), (I-746)+(1.013)+(3.027), (I-746)+(1.013)+(3.028), (I-746)+(1.013)+(3.029), (I-746)+(1.013)+(3.030), (I-746)+(1.013)+(3.031), (I-746)+(1.013)+(5.001), (I-746)+(1.013)+(5.002), (I-746)+(1.013)+(5.003), (I-746)+(1.013)+(5.004), (I-746)+(1.013)+(5.005), (I-746)+(1.013)+(5.006), (I-746)+(1.013)+(5.007), (I-746)+(1.013)+(5.008), (I-746)+(1.013)+(5.009), (I-746)+(1.013)+(5.010), (I-746)+(1.013)+(5.011), (I-746)+(1.013)+(5.012), (I-746)+(1.013)+(5.013), (I-746)+(1.013)+(5.014), (I-746)+(1.013)+(5.015), (I-746)+(1.013)+(5.016), (I-746)+(1.013)+(5.017), (I-746)+(1.013)+(5.018), (I-746)+(1.013)+(5.019), (I-746)+(1.013)+(5.020), (I-746)+(1.013)+(5.021), (I-746)+(1.013)+(5.022), (I-746)+(1.013)+(5.023), (I-746)+(1.013)+(6.001), (I-746)+(1.013)+(6.002), (I-746)+(1.013)+(6.003), (I-746)+(1.013)+(6.004), (I-746)+(1.013)+(7.001), (I-746)+(1.013)+(7.002), (I-746)+(1.013)+(7.003), (I-746)+(1.013)+(7.004), (I-746)+(1.013)+(7.005), (I-746)+(1.013)+(7.006), (I-746)+(1.013)+(9.001), (I-746)+(1.013)+(9.002), (I-746)+(1.013)+(9.003), (I-746)+(1.013)+(9.004), (I-746)+(1.013)+(9.005), (I-746)+(1.013)+(9.006), (I-746)+(1.013)+(9.007), (I-746)+(1.013)+(9.008), (I-746)+(1.013)+(9.009), (I-746)+(1.013)+(14.001), (I-746)+(1.013)+(14.002), (I-746)+(1.013)+(15.008), (I-746)+(1.013)+(15.011), (I-746)+(1.013)+(15.012), (I-746)+(1.013)+(15.016), (I-746)+(1.013)+(15.025), (I-746)+(1.013)+(15.027), (I-746)+(1.013)+(15.047), (I-746)+(1.013)+(15.063), (I-746)+(1.013)+(15.064), (I-746)+(1.013)+(16.001), (I-746)+(1.013)+(16.002), (I-746)+(1.013)+(16.003), (I-746)+(1.013)+(16.004), (I-746)+(1.013)+(16.005), (I-746)+(1.013)+(16.006), (I-746)+(1.013)+(16.007), (I-746)+(1.013)+(16.008), (I-746)+(1.013)+(17.001), (I-746)+(1.013)+(17.002), (I-746)+(1.013)+(17.003), (I-746)+(1.013)+(17.004), (I-746)+(1.013)+(17.005), (I-746)+(1.013)+(17.006), (I-746)+(1.013)+(17.007), (I-746)+(1.013)+(17.008), (I-746)+(1.013)+(17.009), (I-746)+(1.013)+(17.010), (I-746)+(1.013)+(17.011), (I-746)+(1.013)+(17.012), (I-746)+(1.013)+(18.001),

(I-746)+(1.014)+(1.015), (I-746)+(1.014)+(1.016), (I-746)+(1.014)+(1.017), (I-746)+(1.014)+(1.018), (I-746)+(1.014)+(1.019), (I-746)+(1.014)+(1.020), (I-746)+(1.014)+(1.021), (I-746)+(1.014)+(1.022), (I-746)+(1.014)+(1.023), (I-746)+(1.014)+(1.024), (I-746)+(1.014)+(1.025), (I-746)+(1.014)+(1.026), (I-746)+(1.014)+(1.027), (I-746)+(1.014)+(1.028), (I-746)+(1.014)+(1.029), (I-746)+(1.014)+(1.030), (I-746)+(1.014)+(1.031), (I-746)+(1.014)+(1.032), (I-746)+(1.014)+(1.033), (I-746)+(1.014)+(1.034), (I-746)+(1.014)+(1.035), (I-746)+(1.014)+(1.036), (I-746)+(1.014)+(1.037), (I-746)+(1.014)+(1.038), (I-746)+(1.014)+(1.039), (I-746)+(1.014)+(1.040), (I-746)+(1.014)+(1.041), (I-746)+(1.014)+(1.042), (I-746)+(1.014)+(1.043), (I-746)+(1.014)+(1.044), (I-746)+(1.014)+(1.045), (I-746)+(1.014)+(1.046), (I-746)+(1.014)+(1.047), (I-746)+(1.014)+(1.048), (I-746)+(1.014)+(1.049), (I-746)+(1.014)+(1.050), (I-746)+(1.014)+(1.051), (I-746)+(1.014)+(1.052), (I-746)+(1.014)+(1.053), (I-746)+(1.014)+(1.054), (I-746)+(1.014)+(1.055), (I-746)+(1.014)+(1.056), (I-746)+(1.014)+(1.057), (I-746)+(1.014)+(1.058), (I-746)+(1.014)+(1.059), (I-746)+(1.014)+(1.060), (I-746)+(1.014)+(1.061), (I-746)+(1.014)+(1.062), (I-746)+(1.014)+(1.063), (I-746)+(1.014)+(1.064), (I-746)+(1.014)+(1.065), (I-746)+(1.014)+(1.066), (I-746)+(1.014)+(1.067), (I-746)+(1.014)+(1.068), (I-746)+(1.014)+(1.069), (I-746)+(1.014)+(1.070), (I-746)+(1.014)+(1.071), (I-746)+(1.014)+(1.072), (I-746)+(1.014)+(1.073), (I-746)+(1.014)+(1.074), (I-746)+(1.014)+(1.075), (I-746)+(1.014)+(1.076), (I-746)+(1.014)+(1.077), (I-746)+(1.014)+(1.078), (I-746)+(1.014)+(1.079), (I-746)+(1.014)+(1.080), (I-746)+(1.014)+(1.081), (I-746)+(1.014)+(1.082), (I-746)+(1.014)+(1.083), (I-746)+(1.014)+(1.084), (I-746)+(1.014)+(1.085), (I-746)+(1.014)+(1.086), (I-746)+(1.014)+(1.087), (I-746)+(1.014)+(1.088), (I-746)+(1.014)+(1.089), (I-746)+(1.014)+(1.090), (I-746)+(1.014)+(1.091), (I-746)+(1.014)+(1.092), (I-746)+(1.014)+(2.001), (I-746)+(1.014)+(2.002), (I-746)+(1.014)+(2.003), (I-746)+(1.014)+(2.004), (I-746)+(1.014)+(2.005), (I-746)+(1.014)+(2.006), (I-746)+(1.014)+(2.007), (I-746)+(1.014)+(2.008), (I-746)+(1.014)+(2.009), (I-746)+(1.014)+(2.010), (I-746)+(1.014)+(2.011), (I-746)+(1.014)+(2.012), (I-746)+(1.014)+(2.013), (I-746)+(1.014)+(2.014), (I-746)+(1.014)+(2.015), (I-746)+(1.014)+(2.016), (I-746)+(1.014)+(2.017), (I-746)+(1.014)+(2.018), (I-746)+(1.014)+(2.019), (I-746)+(1.014)+(2.020), (I-746)+(1.014)+(2.021), (I-746)+(1.014)+(2.022), (I-746)+(1.014)+(2.023), (I-746)+(1.014)+(2.024), (I-746)+(1.014)+(2.025), (I-746)+(1.014)+(2.026), (I-746)+(1.014)+(2.027), (I-746)+(1.014)+(2.028), (I-746)+(1.014)+(2.029), (I-746)+(1.014)+(2.030), (I-746)+(1.014)+(2.031), (I-746)+(1.014)+(2.032), (I-746)+(1.014)+(2.033), (I-746)+(1.014)+(2.034), (I-746)+(1.014)+(2.035), (I-746)+(1.014)+(2.036), (I-746)+(1.014)+(2.037), (I-746)+(1.014)+(2.038), (I-746)+(1.014)+(2.039), (I-746)+(1.014)+(2.040), (I-746)+(1.014)+(2.041), (I-746)+(1.014)+(2.042), (I-746)+(1.014)+(2.043), (I-746)+(1.014)+(2.044), (I-746)+(1.014)+(2.045), (I-746)+(1.014)+(2.046), (I-746)+(1.014)+(2.047), (I-746)+(1.014)+(2.048), (I-746)+(1.014)+(2.049), (I-746)+(1.014)+(2.050), (I-746)+(1.014)+(2.051), (I-746)+(1.014)+(2.052), (I-746)+(1.014)+(2.053), (I-746)+(1.014)+(2.054), (I-746)+(1.014)+(2.055), (I-746)+(1.014)+(2.056), (I-746)+(1.014)+(2.057), (I-746)+(1.014)+(2.058), (I-746)+(1.014)+(2.059), (I-746)+(1.014)+(3.001), (I-746)+(1.014)+(3.002), (I-746)+(1.014)+(3.003), (I-746)+(1.014)+(3.004), (I-746)+(1.014)+(3.005), (I-746)+(1.014)+(3.006), (I-746)+(1.014)+(3.007), (I-746)+(1.014)+(3.008), (I-746)+(1.014)+(3.009), (I-746)+(1.014)+(3.010), (I-746)+(1.014)+(3.011), (I-746)+(1.014)+(3.012), (I-746)+(1.014)+(3.013), (I-746)+(1.014)+(3.014), (I-746)+(1.014)+(3.015), (I-746)+(1.014)+(3.016), (I-746)+(1.014)+(3.017), (I-746)+(1.014)+(3.018), (I-746)+(1.014)+(3.019), (I-746)+(1.014)+(3.020), (I-746)+(1.014)+(3.021), (I-746)+(1.014)+(3.022), (I-746)+(1.014)+(3.023), (I-746)+(1.014)+(3.024), (I-746)+(1.014)+(3.025), (I-746)+(1.014)+(3.026), (I-746)+(1.014)+(3.027), (I-746)+(1.014)+(3.028), (I-746)+(1.014)+(3.029), (I-746)+(1.014)+(3.030), (I-746)+(1.014)+(3.031), (I-746)+(1.014)+(5.001), (I-746)+(1.014)+(5.002), (I-746)+(1.014)+(5.003), (I-746)+(1.014)+(5.004), (I-746)+(1.014)+(5.005), (I-746)+(1.014)+(5.006), (I-746)+(1.014)+(5.007), (I-746)+(1.014)+(5.008), (I-746)+(1.014)+(5.009), (I-746)+(1.014)+(5.010), (I-746)+(1.014)+(5.011), (I-746)+(1.014)+(5.012), (I-746)+(1.014)+(5.013), (I-746)+(1.014)+(5.014), (I-746)+(1.014)+(5.015), (I-746)+(1.014)+(5.016), (I-746)+(1.014)+(5.017), (I-746)+(1.014)+(5.018), (I-746)+(1.014)+(5.019), (I-746)+(1.014)+(5.020), (I-746)+(1.014)+(5.021), (I-746)+(1.014)+(5.022), (I-746)+(1.014)+(5.023), (I-746)+(1.014)+(6.001), (I-746)+(1.014)+(6.002), (I-746)+(1.014)+(6.003), (I-746)+(1.014)+(6.004), (I-746)+(1.014)+(7.001), (I-746)+(1.014)+(7.002), (I-746)+(1.014)+(7.003), (I-746)+(1.014)+(7.004), (I-746)+(1.014)+(7.005), (I-746)+(1.014)+(7.006), (I-746)+(1.014)+(9.001), (I-746)+(1.014)+(9.002), (I-746)+(1.014)+(9.003), (I-746)+(1.014)+(9.004), (I-746)+(1.014)+(9.005), (I-746)+(1.014)+(9.006), (I-746)+(1.014)+(9.007), (I-746)+(1.014)+(9.008), (I-746)+(1.014)+(9.009), (I-746)+(1.014)+(14.001), (I-746)+(1.014)+(14.002), (I-746)+(1.014)+(15.008), (I-746)+(1.014)+(15.011), (I-746)+(1.014)+(15.012), (I-746)+(1.014)+(15.016), (I-746)+(1.014)+(15.025), (I-746)+(1.014)+(15.027), (I-746)+(1.014)+(15.047), (I-746)+(1.014)+(15.063), (I-746)+(1.014)+(15.064), (I-746)+(1.014)+(16.001), (I-746)+(1.014)+(16.002), (I-746)+(1.014)+(16.003), (I-746)+(1.014)+(16.004), (I-746)+(1.014)+(16.005), (I-746)+(1.014)+(16.006), (I-746)+(1.014)+(16.007), (I-746)+(1.014)+(16.008), (I-746)+(1.014)+(17.001), (I-746)+(1.014)+(17.002), (I-746)+(1.014)+(17.003), (I-746)+(1.014)+(17.004), (I-746)+(1.014)+(17.005), (I-746)+(1.014)+(17.006), (I-746)+(1.014)+(17.007), (I-746)+(1.014)+(17.008), (I-746)+(1.014)+(17.009), (I-746)+(1.014)+(17.010), (I-746)+(1.014)+(17.011), (I-746)+(1.014)+(17.012), (I-746)+(1.014)+(18.001),

(I-746)+(1.015)+(1.016), (I-746)+(1.015)+(1.017), (I-746)+(1.015)+(1.018), (I-746)+(1.015)+(1.019), (I-746)+(1.015)+(1.020), (I-746)+(1.015)+(1.021), (I-746)+(1.015)+(1.022), (I-746)+(1.015)+(1.023), (I-746)+(1.015)+(1.024), (I-746)+(1.015)+(1.025), (I-746)+(1.015)+(1.026), (I-746)+(1.015)+(1.027), (I-746)+(1.015)+(1.028), (I-746)+(1.015)+(1.029), (I-746)+(1.015)+(1.030), (I-746)+(1.015)+(1.031), (I-746)+(1.015)+(1.032), (I-746)+(1.015)+(1.033), (I-746)+(1.015)+(1.034), (I-746)+(1.015)+(1.035), (I-746)+(1.015)+(1.036), (I-746)+(1.015)+(1.037), (I-746)+(1.015)+(1.038), (I-746)+(1.015)+(1.039), (I-746)+(1.015)+(1.040), (I-746)+(1.015)+(1.041), (I-746)+(1.015)+(1.042), (I-746)+(1.015)+(1.043), (I-746)+(1.015)+(1.044), (I-746)+(1.015)+(1.045), (I-746)+(1.015)+(1.046), (I-746)+(1.015)+(1.047), (I-746)+(1.015)+(1.048), (I-746)+(1.015)+(1.049), (I-746)+(1.015)+(1.050), (I-746)+(1.015)+(1.051), (I-746)+(1.015)+(1.052), (I-746)+(1.015)+(1.053), (I-746)+(1.015)+(1.054), (I-746)+(1.015)+(1.055), (I-746)+(1.015)+(1.056), (I-746)+(1.015)+(1.057), (I-746)+(1.015)+(1.058), (I-746)+(1.015)+(1.059), (I-746)+(1.015)+(1.060), (I-746)+(1.015)+(1.061), (I-746)+(1.015)+(1.062), (I-746)+(1.015)+(1.063), (I-746)+(1.015)+(1.064), (I-746)+(1.015)+(1.065), (I-746)+(1.015)+(1.066), (I-746)+(1.015)+(1.067), (I-746)+(1.015)+(1.068), (I-746)+(1.015)+(1.069), (I-746)+(1.015)+(1.070), (I-746)+(1.015)+(1.071), (I-746)+(1.015)+(1.072), (I-746)+(1.015)+(1.073), (I-746)+(1.015)+(1.074), (I-746)+(1.015)+(1.075), (I-746)+(1.015)+(1.076), (I-746)+(1.015)+(1.077), (I-746)+(1.015)+(1.078), (I-746)+(1.015)+(1.079), (I-746)+(1.015)+(1.080), (I-746)+(1.015)+(1.081), (I-746)+(1.015)+(1.082), (I-746)+(1.015)+(1.083), (I-746)+(1.015)+(1.084), (I-746)+(1.015)+(1.085), (I-746)+(1.015)+(1.086), (I-746)+(1.015)+(1.087), (I-746)+(1.015)+(1.088), (I-746)+(1.015)+(1.089), (I-746)+(1.015)+(1.090), (I-746)+(1.015)+(1.091), (I-746)+(1.015)+(1.092), (I-746)+(1.015)+(2.001), (I-746)+(1.015)+(2.002), (I-746)+(1.015)+(2.003), (I-746)+(1.015)+(2.004), (I-746)+(1.015)+(2.005), (I-746)+(1.015)+(2.006), (I-746)+(1.015)+(2.007), (I-746)+(1.015)+(2.008), (I-746)+(1.015)+(2.009), (I-746)+(1.015)+(2.010), (I-746)+(1.015)+(2.011), (I-746)+(1.015)+(2.012), (I-746)+(1.015)+(2.013), (I-746)+(1.015)+(2.014), (I-746)+(1.015)+(2.015), (I-746)+(1.015)+(2.016), (I-746)+(1.015)+(2.017), (I-746)+(1.015)+(2.018), (I-746)+(1.015)+(2.019), (I-746)+(1.015)+(2.020), (I-746)+(1.015)+(2.021), (I-746)+(1.015)+(2.022), (I-746)+(1.015)+(2.023), (I-746)+(1.015)+(2.024), (I-746)+(1.015)+(2.025), (I-746)+(1.015)+(2.026), (I-746)+(1.015)+(2.027), (I-746)+(1.015)+(2.028), (I-746)+(1.015)+(2.029), (I-746)+(1.015)+(2.030), (I-746)+(1.015)+(2.031), (I-746)+(1.015)+(2.032), (I-746)+(1.015)+(2.033), (I-746)+(1.015)+(2.034), (I-746)+(1.015)+(2.035), (I-746)+(1.015)+(2.036), (I-746)+(1.015)+(2.037), (I-746)+(1.015)+(2.038), (I-746)+(1.015)+(2.039), (I-746)+(1.015)+(2.040), (I-746)+(1.015)+(2.041), (I-746)+(1.015)+(2.042), (I-746)+(1.015)+(2.043), (I-746)+(1.015)+(2.044), (I-746)+(1.015)+(2.045), (I-746)+(1.015)+(2.046), (I-746)+(1.015)+(2.047), (I-746)+(1.015)+(2.048), (I-746)+(1.015)+(2.049), (I-746)+(1.015)+(2.050), (I-746)+(1.015)+(2.051), (I-746)+(1.015)+(2.052), (I-746)+(1.015)+(2.053), (I-746)+(1.015)+(2.054), (I-746)+(1.015)+(2.055), (I-746)+(1.015)+(2.056), (I-746)+(1.015)+(2.057), (I-746)+(1.015)+(2.058), (I-746)+(1.015)+(2.059), (I-746)+(1.015)+(3.001), (I-746)+(1.015)+(3.002), (I-746)+(1.015)+(3.003), (I-746)+(1.015)+(3.004), (I-746)+(1.015)+(3.005), (I-746)+(1.015)+(3.006), (I-746)+(1.015)+(3.007), (I-746)+(1.015)+(3.008), (I-746)+(1.015)+(3.009), (I-746)+(1.015)+(3.010), (I-746)+(1.015)+(3.011), (I-746)+(1.015)+(3.012), (I-746)+(1.015)+(3.013), (I-746)+(1.015)+(3.014), (I-746)+(1.015)+(3.015), (I-746)+(1.015)+(3.016), (I-746)+(1.015)+(3.017), (I-746)+(1.015)+(3.018), (I-746)+(1.015)+(3.019), (I-746)+(1.015)+(3.020), (I-746)+(1.015)+(3.021), (I-746)+(1.015)+(3.022), (I-746)+(1.015)+(3.023), (I-746)+(1.015)+(3.024), (I-746)+(1.015)+(3.025), (I-746)+(1.015)+(3.026), (I-746)+(1.015)+(3.027), (I-746)+(1.015)+(3.028), (I-746)+(1.015)+(3.029), (I-746)+(1.015)+(3.030), (I-746)+(1.015)+(3.031), (I-746)+(1.015)+(5.001), (I-746)+(1.015)+(5.002), (I-746)+(1.015)+(5.003), (I-746)+(1.015)+(5.004), (I-746)+(1.015)+(5.005), (I-746)+(1.015)+(5.006), (I-746)+(1.015)+(5.007), (I-746)+(1.015)+(5.008), (I-746)+(1.015)+(5.009), (I-746)+(1.015)+(5.010), (I-746)+(1.015)+(5.011), (I-746)+(1.015)+(5.012), (I-746)+(1.015)+(5.013), (I-746)+(1.015)+(5.014), (I-746)+(1.015)+(5.015), (I-746)+(1.015)+(5.016), (I-746)+(1.015)+(5.017), (I-746)+(1.015)+(5.018), (I-746)+(1.015)+(5.019), (I-746)+(1.015)+(5.020), (I-746)+(1.015)+(5.021), (I-746)+(1.015)+(5.022), (I-746)+(1.015)+(5.023), (I-746)+(1.015)+(6.001), (I-746)+(1.015)+(6.002), (I-746)+(1.015)+(6.003), (I-746)+(1.015)+(6.004), (I-746)+(1.015)+(7.001), (I-746)+(1.015)+(7.002), (I-746)+(1.015)+(7.003), (I-746)+(1.015)+(7.004), (I-746)+(1.015)+(7.005), (I-746)+(1.015)+(7.006), (I-746)+(1.015)+(9.001), (I-746)+(1.015)+(9.002), (I-746)+(1.015)+(9.003), (I-746)+(1.015)+(9.004), (I-746)+(1.015)+(9.005), (I-746)+(1.015)+(9.006), (I-746)+(1.015)+(9.007), (I-746)+(1.015)+(9.008), (I-746)+(1.015)+(9.009), (I-746)+(1.015)+(14.001), (I-746)+(1.015)+(14.002), (I-746)+(1.015)+(15.008), (I-746)+(1.015)+(15.011), (I-746)+(1.015)+(15.012), (I-746)+(1.015)+(15.016), (I-746)+(1.015)+(15.025), (I-746)+(1.015)+(15.027), (I-746)+(1.015)+(15.047), (I-746)+(1.015)+(15.063), (I-746)+(1.015)+(15.064), (I-746)+(1.015)+(16.001), (I-746)+(1.015)+(16.002), (I-746)+(1.015)+(16.003), (I-746)+(1.015)+(16.004), (I-746)+(1.015)+(16.005), (I-746)+(1.015)+(16.006), (I-746)+(1.015)+(16.007), (I-746)+(1.015)+(16.008), (I-746)+(1.015)+(17.001), (I-746)+(1.015)+(17.002), (I-746)+(1.015)+(17.003), (I-746)+(1.015)+(17.004), (I-746)+(1.015)+(17.005), (I-746)+(1.015)+(17.006), (I-746)+(1.015)+(17.007), (I-746)+(1.015)+(17.008), (I-746)+(1.015)+(17.009), (I-746)+(1.015)+(17.010), (I-746)+(1.015)+(17.011), (I-746)+(1.015)+(17.012), (I-746)+(1.015)+(18.001),

(I-746)+(1.016)+(1.017), (I-746)+(1.016)+(1.018), (I-746)+(1.016)+(1.019), (I-746)+(1.016)+(1.020), (I-746)+(1.016)+(1.021), (I-746)+(1.016)+(1.022), (I-746)+(1.016)+(1.023), (I-746)+(1.016)+(1.024), (I-746)+(1.016)+(1.025), (I-746)+(1.016)+(1.026), (I-746)+(1.016)+(1.027), (I-746)+(1.016)+(1.028), (I-746)+(1.016)+(1.029), (I-746)+(1.016)+(1.030), (I-746)+(1.016)+(1.031), (I-746)+(1.016)+(1.032), (I-746)+(1.016)+(1.033), (I-746)+(1.016)+(1.034), (I-746)+(1.016)+(1.035), (I-746)+(1.016)+(1.036), (I-746)+(1.016)+(1.037), (I-746)+(1.016)+(1.038), (I-746)+(1.016)+(1.039), (I-746)+(1.016)+(1.040), (I-746)+(1.016)+(1.041), (I-746)+(1.016)+(1.042), (I-746)+(1.016)+(1.043), (I-746)+(1.016)+(1.044), (I-746)+(1.016)+(1.045), (I-746)+(1.016)+(1.046), (I-746)+(1.016)+(1.047), (I-746)+(1.016)+(1.048), (I-746)+(1.016)+(1.049), (I-746)+(1.016)+(1.050), (I-746)+(1.016)+(1.051), (I-746)+(1.016)+(1.052), (I-746)+(1.016)+(1.053), (I-746)+(1.016)+(1.054), (I-746)+(1.016)+(1.055), (I-746)+(1.016)+(1.056), (I-746)+(1.016)+(1.057), (I-746)+(1.016)+(1.058), (I-746)+(1.016)+(1.059), (I-746)+(1.016)+(1.060), (I-746)+(1.016)+(1.061), (I-746)+(1.016)+(1.062), (I-746)+(1.016)+(1.063), (I-746)+(1.016)+(1.064), (I-746)+(1.016)+(1.065), (I-746)+(1.016)+(1.066), (I-746)+(1.016)+(1.067), (I-746)+(1.016)+(1.068), (I-746)+(1.016)+(1.069), (I-746)+(1.016)+(1.070), (I-746)+(1.016)+(1.071), (I-746)+(1.016)+(1.072), (I-746)+(1.016)+(1.073), (I-746)+(1.016)+(1.074), (I-746)+(1.016)+(1.075), (I-746)+(1.016)+(1.076), (I-746)+(1.016)+(1.077), (I-746)+(1.016)+(1.078), (I-746)+(1.016)+(1.079), (I-746)+(1.016)+(1.080), (I-746)+(1.016)+(1.081), (I-746)+(1.016)+(1.082), (I-746)+(1.016)+(1.083), (I-746)+(1.016)+(1.084), (I-746)+(1.016)+(1.085), (I-746)+(1.016)+(1.086), (I-746)+(1.016)+(1.087), (I-746)+(1.016)+(1.088), (I-746)+(1.016)+(1.089), (I-746)+(1.016)+(1.090), (I-746)+(1.016)+(1.091), (I-746)+(1.016)+(1.092), (I-746)+(1.016)+(2.001), (I-746)+(1.016)+(2.002), (I-746)+(1.016)+(2.003), (I-746)+(1.016)+(2.004), (I-746)+(1.016)+(2.005), (I-746)+(1.016)+(2.006), (I-746)+(1.016)+(2.007), (I-746)+(1.016)+(2.008), (I-746)+(1.016)+(2.009), (I-746)+(1.016)+(2.010), (I-746)+(1.016)+(2.011), (I-746)+(1.016)+(2.012), (I-746)+(1.016)+(2.013), (I-746)+(1.016)+(2.014), (I-746)+(1.016)+(2.015), (I-746)+(1.016)+(2.016), (I-746)+(1.016)+(2.017), (I-746)+(1.016)+(2.018), (I-746)+(1.016)+(2.019), (I-746)+(1.016)+(2.020), (I-746)+(1.016)+(2.021), (I-746)+(1.016)+(2.022), (I-746)+(1.016)+(2.023), (I-746)+(1.016)+(2.024), (I-746)+(1.016)+(2.025), (I-746)+(1.016)+(2.026), (I-746)+(1.016)+(2.027), (I-746)+(1.016)+(2.028), (I-746)+(1.016)+(2.029), (I-746)+(1.016)+(2.030), (I-746)+(1.016)+(2.031), (I-746)+(1.016)+(2.032), (I-746)+(1.016)+(2.033), (I-746)+(1.016)+(2.034), (I-746)+(1.016)+(2.035), (I-746)+(1.016)+(2.036), (I-746)+(1.016)+(2.037), (I-746)+(1.016)+(2.038), (I-746)+(1.016)+(2.039), (I-746)+(1.016)+(2.040), (I-746)+(1.016)+(2.041), (I-746)+(1.016)+(2.042), (I-746)+(1.016)+(2.043), (I-746)+(1.016)+(2.044), (I-746)+(1.016)+(2.045), (I-746)+(1.016)+(2.046), (I-746)+(1.016)+(2.047), (I-746)+(1.016)+(2.048), (I-746)+(1.016)+(2.049), (I-746)+(1.016)+(2.050), (I-746)+(1.016)+(2.051), (I-746)+(1.016)+(2.052), (I-746)+(1.016)+(2.053), (I-746)+(1.016)+(2.054), (I-746)+(1.016)+(2.055), (I-746)+(1.016)+(2.056), (I-746)+(1.016)+(2.057), (I-746)+(1.016)+(2.058), (I-746)+(1.016)+(2.059), (I-746)+(1.016)+(3.001), (I-746)+(1.016)+(3.002), (I-746)+(1.016)+(3.003), (I-746)+(1.016)+(3.004), (I-746)+(1.016)+(3.005), (I-746)+(1.016)+(3.006), (I-746)+(1.016)+(3.007), (I-746)+(1.016)+(3.008), (I-746)+(1.016)+(3.009), (I-746)+(1.016)+(3.010), (I-746)+(1.016)+(3.011), (I-746)+(1.016)+(3.012), (I-746)+(1.016)+(3.013), (I-746)+(1.016)+(3.014), (I-746)+(1.016)+(3.015), (I-746)+(1.016)+(3.016), (I-746)+(1.016)+(3.017), (I-746)+(1.016)+(3.018), (I-746)+(1.016)+(3.019), (I-746)+(1.016)+(3.020), (I-746)+(1.016)+(3.021), (I-746)+(1.016)+(3.022), (I-746)+(1.016)+(3.023), (I-746)+(1.016)+(3.024), (I-746)+(1.016)+(3.025), (I-746)+(1.016)+(3.026), (I-746)+(1.016)+(3.027), (I-746)+(1.016)+(3.028), (I-746)+(1.016)+(3.029), (I-746)+(1.016)+(3.030), (I-746)+(1.016)+(3.031), (I-746)+(1.016)+(5.001), (I-746)+(1.016)+(5.002), (I-746)+(1.016)+(5.003), (I-746)+(1.016)+(5.004), (I-746)+(1.016)+(5.005), (I-746)+(1.016)+(5.006), (I-746)+(1.016)+(5.007), (I-746)+(1.016)+(5.008), (I-746)+(1.016)+(5.009), (I-746)+(1.016)+(5.010), (I-746)+(1.016)+(5.011), (I-746)+(1.016)+(5.012), (I-746)+(1.016)+(5.013), (I-746)+(1.016)+(5.014), (I-746)+(1.016)+(5.015), (I-746)+(1.016)+(5.016), (I-746)+(1.016)+(5.017), (I-746)+(1.016)+(5.018), (I-746)+(1.016)+(5.019), (I-746)+(1.016)+(5.020), (I-746)+(1.016)+(5.021), (I-746)+(1.016)+(5.022), (I-746)+(1.016)+(5.023), (I-746)+(1.016)+(6.001), (I-746)+(1.016)+(6.002), (I-746)+(1.016)+(6.003), (I-746)+(1.016)+(6.004), (I-746)+(1.016)+(7.001), (I-746)+(1.016)+(7.002), (I-746)+(1.016)+(7.003), (I-746)+(1.016)+(7.004), (I-746)+(1.016)+(7.005), (I-746)+(1.016)+(7.006), (I-746)+(1.016)+(9.001), (I-746)+(1.016)+(9.002), (I-746)+(1.016)+(9.003), (I-746)+(1.016)+(9.004), (I-746)+(1.016)+(9.005), (I-746)+(1.016)+(9.006), (I-746)+(1.016)+(9.007), (I-746)+(1.016)+(9.008), (I-746)+(1.016)+(9.009), (I-746)+(1.016)+(14.001), (I-746)+(1.016)+(14.002), (I-746)+(1.016)+(15.008), (I-746)+(1.016)+(15.011), (I-746)+(1.016)+(15.012), (I-746)+(1.016)+(15.016), (I-746)+(1.016)+(15.025), (I-746)+(1.016)+(15.027), (I-746)+(1.016)+(15.047), (I-746)+(1.016)+(15.063), (I-746)+(1.016)+(15.064), (I-746)+(1.016)+(16.001), (I-746)+(1.016)+(16.002), (I-746)+(1.016)+(16.003), (I-746)+(1.016)+(16.004), (I-746)+(1.016)+(16.005), (I-746)+(1.016)+(16.006), (I-746)+(1.016)+(16.007), (I-746)+(1.016)+(16.008), (I-746)+(1.016)+(17.001), (I-746)+(1.016)+(17.002), (I-746)+(1.016)+(17.003), (I-746)+(1.016)+(17.004), (I-746)+(1.016)+(17.005), (I-746)+(1.016)+(17.006), (I-746)+(1.016)+(17.007), (I-746)+(1.016)+(17.008), (I-746)+(1.016)+(17.009), (I-746)+(1.016)+(17.010), (I-746)+(1.016)+(17.011), (I-746)+(1.016)+(17.012), (I-746)+(1.016)+(18.001),

(I-746)+(1.017)+(1.018), (I-746)+(1.017)+(1.019), (I-746)+(1.017)+(1.020), (I-746)+(1.017)+(1.021), (I-746)+(1.017)+(1.022), (I-746)+(1.017)+(1.023), (I-746)+(1.017)+(1.024), (I-746)+(1.017)+(1.025), (I-746)+(1.017)+(1.026), (I-746)+(1.017)+(1.027), (I-746)+(1.017)+(1.028), (I-746)+(1.017)+(1.029), (I-746)+(1.017)+(1.030), (I-746)+(1.017)+(1.031), (I-746)+(1.017)+(1.032), (I-746)+(1.017)+(1.033), (I-746)+(1.017)+(1.034), (I-746)+(1.017)+(1.035), (I-746)+(1.017)+(1.036), (I-746)+(1.017)+(1.037), (I-746)+(1.017)+(1.038), (I-746)+(1.017)+(1.039), (I-746)+(1.017)+(1.040), (I-746)+(1.017)+(1.041), (I-746)+(1.017)+(1.042), (I-746)+(1.017)+(1.043), (I-746)+(1.017)+(1.044), (I-746)+(1.017)+(1.045), (I-746)+(1.017)+(1.046), (I-746)+(1.017)+(1.047), (I-746)+(1.017)+(1.048), (I-746)+(1.017)+(1.049), (I-746)+(1.017)+(1.050), (I-746)+(1.017)+(1.051), (I-746)+(1.017)+(1.052), (I-746)+(1.017)+(1.053), (I-746)+(1.017)+(1.054), (I-746)+(1.017)+(1.055), (I-746)+(1.017)+(1.056), (I-746)+(1.017)+(1.057), (I-746)+(1.017)+(1.058), (I-746)+(1.017)+(1.059), (I-746)+(1.017)+(1.060), (I-746)+(1.017)+(1.061), (I-746)+(1.017)+(1.062), (I-746)+(1.017)+(1.063), (I-746)+(1.017)+(1.064), (I-746)+(1.017)+(1.065), (I-746)+(1.017)+(1.066), (I-746)+(1.017)+(1.067), (I-746)+(1.017)+(1.068), (I-746)+(1.017)+(1.069), (I-746)+(1.017)+(1.070), (I-746)+(1.017)+(1.071), (I-746)+(1.017)+(1.072), (I-746)+(1.017)+(1.073), (I-746)+(1.017)+(1.074), (I-746)+(1.017)+(1.075), (I-746)+(1.017)+(1.076), (I-746)+(1.017)+(1.077), (I-746)+(1.017)+(1.078), (I-746)+(1.017)+(1.079), (I-746)+(1.017)+(1.080), (I-746)+(1.017)+(1.081), (I-746)+(1.017)+(1.082), (I-746)+(1.017)+(1.083), (I-746)+(1.017)+(1.084), (I-746)+(1.017)+(1.085), (I-746)+(1.017)+(1.086), (I-746)+(1.017)+(1.087), (I-746)+(1.017)+(1.088), (I-746)+(1.017)+(1.089), (I-746)+(1.017)+(1.090), (I-746)+(1.017)+(1.091), (I-746)+(1.017)+(1.092), (I-746)+(1.017)+(2.001), (I-746)+(1.017)+(2.002), (I-746)+(1.017)+(2.003), (I-746)+(1.017)+(2.004), (I-746)+(1.017)+(2.005), (I-746)+(1.017)+(2.006), (I-746)+(1.017)+(2.007), (I-746)+(1.017)+(2.008), (I-746)+(1.017)+(2.009), (I-746)+(1.017)+(2.010), (I-746)+(1.017)+(2.011), (I-746)+(1.017)+(2.012), (I-746)+(1.017)+(2.013), (I-746)+(1.017)+(2.014), (I-746)+(1.017)+(2.015), (I-746)+(1.017)+(2.016), (I-746)+(1.017)+(2.017), (I-746)+(1.017)+(2.018), (I-746)+(1.017)+(2.019), (I-746)+(1.017)+(2.020), (I-746)+(1.017)+(2.021), (I-746)+(1.017)+(2.022), (I-746)+(1.017)+(2.023), (I-746)+(1.017)+(2.024), (I-746)+(1.017)+(2.025), (I-746)+(1.017)+(2.026), (I-746)+(1.017)+(2.027), (I-746)+(1.017)+(2.028), (I-746)+(1.017)+(2.029), (I-746)+(1.017)+(2.030), (I-746)+(1.017)+(2.031), (I-746)+(1.017)+(2.032), (I-746)+(1.017)+(2.033), (I-746)+(1.017)+(2.034), (I-746)+(1.017)+(2.035), (I-746)+(1.017)+(2.036), (I-746)+(1.017)+(2.037), (I-746)+(1.017)+(2.038), (I-746)+(1.017)+(2.039), (I-746)+(1.017)+(2.040), (I-746)+(1.017)+(2.041), (I-746)+(1.017)+(2.042), (I-746)+(1.017)+(2.043), (I-746)+(1.017)+(2.044), (I-746)+(1.017)+(2.045), (I-746)+(1.017)+(2.046), (I-746)+(1.017)+(2.047), (I-746)+(1.017)+(2.048), (I-746)+(1.017)+(2.049), (I-746)+(1.017)+(2.050), (I-746)+(1.017)+(2.051), (I-746)+(1.017)+(2.052), (I-746)+(1.017)+(2.053), (I-746)+(1.017)+(2.054), (I-746)+(1.017)+(2.055), (I-746)+(1.017)+(2.056), (I-746)+(1.017)+(2.057), (I-746)+(1.017)+(2.058), (I-746)+(1.017)+(2.059), (I-746)+(1.017)+(3.001), (I-746)+(1.017)+(3.002), (I-746)+(1.017)+(3.003), (I-746)+(1.017)+(3.004), (I-746)+(1.017)+(3.005), (I-746)+(1.017)+(3.006), (I-746)+(1.017)+(3.007), (I-746)+(1.017)+(3.008), (I-746)+(1.017)+(3.009), (I-746)+(1.017)+(3.010), (I-746)+(1.017)+(3.011), (I-746)+(1.017)+(3.012), (I-746)+(1.017)+(3.013), (I-746)+(1.017)+(3.014), (I-746)+(1.017)+(3.015), (I-746)+(1.017)+(3.016), (I-746)+(1.017)+(3.017), (I-746)+(1.017)+(3.018), (I-746)+(1.017)+(3.019), (I-746)+(1.017)+(3.020), (I-746)+(1.017)+(3.021), (I-746)+(1.017)+(3.022), (I-746)+(1.017)+(3.023), (I-746)+(1.017)+(3.024), (I-746)+(1.017)+(3.025), (I-746)+(1.017)+(3.026), (I-746)+(1.017)+(3.027), (I-746)+(1.017)+(3.028), (I-746)+(1.017)+(3.029), (I-746)+(1.017)+(3.030), (I-746)+(1.017)+(3.031), (I-746)+(1.017)+(5.001), (I-746)+(1.017)+(5.002), (I-746)+(1.017)+(5.003), (I-746)+(1.017)+(5.004), (I-746)+(1.017)+(5.005), (I-746)+(1.017)+(5.006), (I-746)+(1.017)+(5.007), (I-746)+(1.017)+(5.008), (I-746)+(1.017)+(5.009), (I-746)+(1.017)+(5.010), (I-746)+(1.017)+(5.011), (I-746)+(1.017)+(5.012), (I-746)+(1.017)+(5.013), (I-746)+(1.017)+(5.014), (I-746)+(1.017)+(5.015), (I-746)+(1.017)+(5.016), (I-746)+(1.017)+(5.017), (I-746)+(1.017)+(5.018), (I-746)+(1.017)+(5.019), (I-746)+(1.017)+(5.020), (I-746)+(1.017)+(5.021), (I-746)+(1.017)+(5.022), (I-746)+(1.017)+(5.023), (I-746)+(1.017)+(6.001), (I-746)+(1.017)+(6.002), (I-746)+(1.017)+(6.003), (I-746)+(1.017)+(6.004), (I-746)+(1.017)+(7.001), (I-746)+(1.017)+(7.002), (I-746)+(1.017)+(7.003), (I-746)+(1.017)+(7.004), (I-746)+(1.017)+(7.005), (I-746)+(1.017)+(7.006), (I-746)+(1.017)+(9.001), (I-746)+(1.017)+(9.002), (I-746)+(1.017)+(9.003), (I-746)+(1.017)+(9.004), (I-746)+(1.017)+(9.005), (I-746)+(1.017)+(9.006), (I-746)+(1.017)+(9.007), (I-746)+(1.017)+(9.008), (I-746)+(1.017)+(9.009), (I-746)+(1.017)+(14.001), (I-746)+(1.017)+(14.002), (I-746)+(1.017)+(15.008), (I-746)+(1.017)+(15.011), (I-746)+(1.017)+(15.012), (I-746)+(1.017)+(15.016), (I-746)+(1.017)+(15.025), (I-746)+(1.017)+(15.027), (I-746)+(1.017)+(15.047), (I-746)+(1.017)+(15.063), (I-746)+(1.017)+(15.064), (I-746)+(1.017)+(16.001), (I-746)+(1.017)+(16.002), (I-746)+(1.017)+(16.003), (I-746)+(1.017)+(16.004), (I-746)+(1.017)+(16.005), (I-746)+(1.017)+(16.006), (I-746)+(1.017)+(16.007), (I-746)+(1.017)+(16.008), (I-746)+(1.017)+(17.001), (I-746)+(1.017)+(17.002), (I-746)+(1.017)+(17.003), (I-746)+(1.017)+(17.004), (I-746)+(1.017)+(17.005), (I-746)+(1.017)+(17.006), (I-746)+(1.017)+(17.007), (I-746)+(1.017)+(17.008), (I-746)+(1.017)+(17.009), (I-746)+(1.017)+(17.010), (I-746)+(1.017)+(17.011), (I-746)+(1.017)+(17.012), (I-746)+(1.017)+(18.001),

(I-746)+(1.018)+(1.019), (I-746)+(1.018)+(1.020), (I-746)+(1.018)+(1.021), (I-746)+(1.018)+(1.022), (I-746)+(1.018)+(1.023), (I-746)+(1.018)+(1.024), (I-746)+(1.018)+(1.025), (I-746)+(1.018)+(1.026), (I-746)+(1.018)+(1.027), (I-746)+(1.018)+(1.028), (I-746)+(1.018)+(1.029), (I-746)+(1.018)+(1.030), (I-746)+(1.018)+(1.031), (I-746)+(1.018)+(1.032), (I-746)+(1.018)+(1.033), (I-746)+(1.018)+(1.034), (I-746)+(1.018)+(1.035), (I-746)+(1.018)+(1.036), (I-746)+(1.018)+(1.037), (I-746)+(1.018)+(1.038), (I-746)+(1.018)+(1.039), (I-746)+(1.018)+(1.040), (I-746)+(1.018)+(1.041), (I-746)+(1.018)+(1.042), (I-746)+(1.018)+(1.043), (I-746)+(1.018)+(1.044), (I-746)+(1.018)+(1.045), (I-746)+(1.018)+(1.046), (I-746)+(1.018)+(1.047), (I-746)+(1.018)+(1.048), (I-746)+(1.018)+(1.049), (I-746)+(1.018)+(1.050), (I-746)+(1.018)+(1.051), (I-746)+(1.018)+(1.052), (I-746)+(1.018)+(1.053), (I-746)+(1.018)+(1.054), (I-746)+(1.018)+(1.055), (I-746)+(1.018)+(1.056), (I-746)+(1.018)+(1.057), (I-746)+(1.018)+(1.058), (I-746)+(1.018)+(1.059), (I-746)+(1.018)+(1.060), (I-746)+(1.018)+(1.061), (I-746)+(1.018)+(1.062), (I-746)+(1.018)+(1.063), (I-746)+(1.018)+(1.064), (I-746)+(1.018)+(1.065), (I-746)+(1.018)+(1.066), (I-746)+(1.018)+(1.067), (I-746)+(1.018)+(1.068), (I-746)+(1.018)+(1.069), (I-746)+(1.018)+(1.070), (I-746)+(1.018)+(1.071), (I-746)+(1.018)+(1.072), (I-746)+(1.018)+(1.073), (I-746)+(1.018)+(1.074), (I-746)+(1.018)+(1.075), (I-746)+(1.018)+(1.076), (I-746)+(1.018)+(1.077), (I-746)+(1.018)+(1.078), (I-746)+(1.018)+(1.079), (I-746)+(1.018)+(1.080), (I-746)+(1.018)+(1.081), (I-746)+(1.018)+(1.082), (I-746)+(1.018)+(1.083), (I-746)+(1.018)+(1.084), (I-746)+(1.018)+(1.085), (I-746)+(1.018)+(1.086), (I-746)+(1.018)+(1.087), (I-746)+(1.018)+(1.088), (I-746)+(1.018)+(1.089), (I-746)+(1.018)+(1.090), (I-746)+(1.018)+(1.091), (I-746)+(1.018)+(1.092), (I-746)+(1.018)+(2.001), (I-746)+(1.018)+(2.002), (I-746)+(1.018)+(2.003), (I-746)+(1.018)+(2.004), (I-746)+(1.018)+(2.005), (I-746)+(1.018)+(2.006), (I-746)+(1.018)+(2.007), (I-746)+(1.018)+(2.008), (I-746)+(1.018)+(2.009), (I-746)+(1.018)+(2.010), (I-746)+(1.018)+(2.011), (I-746)+(1.018)+(2.012), (I-746)+(1.018)+(2.013), (I-746)+(1.018)+(2.014), (I-746)+(1.018)+(2.015), (I-746)+(1.018)+(2.016), (I-746)+(1.018)+(2.017), (I-746)+(1.018)+(2.018), (I-746)+(1.018)+(2.019), (I-746)+(1.018)+(2.020), (I-746)+(1.018)+(2.021), (I-746)+(1.018)+(2.022), (I-746)+(1.018)+(2.023), (I-746)+(1.018)+(2.024), (I-746)+(1.018)+(2.025), (I-746)+(1.018)+(2.026), (I-746)+(1.018)+(2.027), (I-746)+(1.018)+(2.028), (I-746)+(1.018)+(2.029), (I-746)+(1.018)+(2.030), (I-746)+(1.018)+(2.031), (I-746)+(1.018)+(2.032), (I-746)+(1.018)+(2.033), (I-746)+(1.018)+(2.034), (I-746)+(1.018)+(2.035), (I-746)+(1.018)+(2.036), (I-746)+(1.018)+(2.037), (I-746)+(1.018)+(2.038), (I-746)+(1.018)+(2.039), (I-746)+(1.018)+(2.040), (I-746)+(1.018)+(2.041), (I-746)+(1.018)+(2.042), (I-746)+(1.018)+(2.043), (I-746)+(1.018)+(2.044), (I-746)+(1.018)+(2.045), (I-746)+(1.018)+(2.046), (I-746)+(1.018)+(2.047), (I-746)+(1.018)+(2.048), (I-746)+(1.018)+(2.049), (I-746)+(1.018)+(2.050), (I-746)+(1.018)+(2.051), (I-746)+(1.018)+(2.052), (I-746)+(1.018)+(2.053), (I-746)+(1.018)+(2.054), (I-746)+(1.018)+(2.055), (I-746)+(1.018)+(2.056), (I-746)+(1.018)+(2.057), (I-746)+(1.018)+(2.058), (I-746)+(1.018)+(2.059), (I-746)+(1.018)+(3.001), (I-746)+(1.018)+(3.002), (I-746)+(1.018)+(3.003), (I-746)+(1.018)+(3.004), (I-746)+(1.018)+(3.005), (I-746)+(1.018)+(3.006), (I-746)+(1.018)+(3.007), (I-746)+(1.018)+(3.008), (I-746)+(1.018)+(3.009), (I-746)+(1.018)+(3.010), (I-746)+(1.018)+(3.011), (I-746)+(1.018)+(3.012), (I-746)+(1.018)+(3.013), (I-746)+(1.018)+(3.014), (I-746)+(1.018)+(3.015), (I-746)+(1.018)+(3.016), (I-746)+(1.018)+(3.017), (I-746)+(1.018)+(3.018), (I-746)+(1.018)+(3.019), (I-746)+(1.018)+(3.020), (I-746)+(1.018)+(3.021), (I-746)+(1.018)+(3.022), (I-746)+(1.018)+(3.023), (I-746)+(1.018)+(3.024), (I-746)+(1.018)+(3.025), (I-746)+(1.018)+(3.026), (I-746)+(1.018)+(3.027), (I-746)+(1.018)+(3.028), (I-746)+(1.018)+(3.029), (I-746)+(1.018)+(3.030), (I-746)+(1.018)+(3.031), (I-746)+(1.018)+(5.001), (I-746)+(1.018)+(5.002), (I-746)+(1.018)+(5.003), (I-746)+(1.018)+(5.004), (I-746)+(1.018)+(5.005), (I-746)+(1.018)+(5.006), (I-746)+(1.018)+(5.007), (I-746)+(1.018)+(5.008), (I-746)+(1.018)+(5.009), (I-746)+(1.018)+(5.010), (I-746)+(1.018)+(5.011), (I-746)+(1.018)+(5.012), (I-746)+(1.018)+(5.013), (I-746)+(1.018)+(5.014), (I-746)+(1.018)+(5.015), (I-746)+(1.018)+(5.016), (I-746)+(1.018)+(5.017), (I-746)+(1.018)+(5.018), (I-746)+(1.018)+(5.019), (I-746)+(1.018)+(5.020), (I-746)+(1.018)+(5.021), (I-746)+(1.018)+(5.022), (I-746)+(1.018)+(5.023), (I-746)+(1.018)+(6.001), (I-746)+(1.018)+(6.002), (I-746)+(1.018)+(6.003), (I-746)+(1.018)+(6.004), (I-746)+(1.018)+(7.001), (I-746)+(1.018)+(7.002), (I-746)+(1.018)+(7.003), (I-746)+(1.018)+(7.004), (I-746)+(1.018)+(7.005), (I-746)+(1.018)+(7.006), (I-746)+(1.018)+(9.001), (I-746)+(1.018)+(9.002), (I-746)+(1.018)+(9.003), (I-746)+(1.018)+(9.004), (I-746)+(1.018)+(9.005), (I-746)+(1.018)+(9.006), (I-746)+(1.018)+(9.007), (I-746)+(1.018)+(9.008), (I-746)+(1.018)+(9.009), (I-746)+(1.018)+(14.001), (I-746)+(1.018)+(14.002), (I-746)+(1.018)+(15.008), (I-746)+(1.018)+(15.011), (I-746)+(1.018)+(15.012), (I-746)+(1.018)+(15.016), (I-746)+(1.018)+(15.025), (I-746)+(1.018)+(15.027), (I-746)+(1.018)+(15.047), (I-746)+(1.018)+(15.063), (I-746)+(1.018)+(15.064), (I-746)+(1.018)+(16.001), (I-746)+(1.018)+(16.002), (I-746)+(1.018)+(16.003), (I-746)+(1.018)+(16.004), (I-746)+(1.018)+(16.005), (I-746)+(1.018)+(16.006), (I-746)+(1.018)+(16.007), (I-746)+(1.018)+(16.008), (I-746)+(1.018)+(17.001), (I-746)+(1.018)+(17.002), (I-746)+(1.018)+(17.003), (I-746)+(1.018)+(17.004), (I-746)+(1.018)+(17.005), (I-746)+(1.018)+(17.006), (I-746)+(1.018)+(17.007), (I-746)+(1.018)+(17.008), (I-746)+(1.018)+(17.009), (I-746)+(1.018)+(17.010), (I-746)+(1.018)+(17.011), (I-746)+(1.018)+(17.012), (I-746)+(1.018)+(18.001),

(I-746)+(1.019)+(1.020), (I-746)+(1.019)+(1.021), (I-746)+(1.019)+(1.022), (I-746)+(1.019)+(1.023), (I-746)+(1.019)+(1.024), (I-746)+(1.019)+(1.025), (I-746)+(1.019)+(1.026), (I-746)+(1.019)+(1.027), (I-746)+(1.019)+(1.028), (I-746)+(1.019)+(1.029), (I-746)+(1.019)+(1.030), (I-746)+(1.019)+(1.031), (I-746)+(1.019)+(1.032), (I-746)+(1.019)+(1.033), (I-746)+(1.019)+(1.034), (I-746)+(1.019)+(1.035), (I-746)+(1.019)+(1.036), (I-746)+(1.019)+(1.037), (I-746)+(1.019)+(1.038), (I-746)+(1.019)+(1.039), (I-746)+(1.019)+(1.040), (I-746)+(1.019)+(1.041), (I-746)+(1.019)+(1.042), (I-746)+(1.019)+(1.043), (I-746)+(1.019)+(1.044), (I-746)+(1.019)+(1.045), (I-746)+(1.019)+(1.046), (I-746)+(1.019)+(1.047), (I-746)+(1.019)+(1.048), (I-746)+(1.019)+(1.049), (I-746)+(1.019)+(1.050), (I-746)+(1.019)+(1.051), (I-746)+(1.019)+(1.052), (I-746)+(1.019)+(1.053), (I-746)+(1.019)+(1.054), (I-746)+(1.019)+(1.055), (I-746)+(1.019)+(1.056), (I-746)+(1.019)+(1.057), (I-746)+(1.019)+(1.058), (I-746)+(1.019)+(1.059), (I-746)+(1.019)+(1.060), (I-746)+(1.019)+(1.061), (I-746)+(1.019)+(1.062), (I-746)+(1.019)+(1.063), (I-746)+(1.019)+(1.064), (I-746)+(1.019)+(1.065), (I-746)+(1.019)+(1.066), (I-746)+(1.019)+(1.067), (I-746)+(1.019)+(1.068), (I-746)+(1.019)+(1.069), (I-746)+(1.019)+(1.070), (I-746)+(1.019)+(1.071), (I-746)+(1.019)+(1.072), (I-746)+(1.019)+(1.073), (I-746)+(1.019)+(1.074), (I-746)+(1.019)+(1.075), (I-746)+(1.019)+(1.076), (I-746)+(1.019)+(1.077), (I-746)+(1.019)+(1.078), (I-746)+(1.019)+(1.079), (I-746)+(1.019)+(1.080), (I-746)+(1.019)+(1.081), (I-746)+(1.019)+(1.082), (I-746)+(1.019)+(1.083), (I-746)+(1.019)+(1.084), (I-746)+(1.019)+(1.085), (I-746)+(1.019)+(1.086), (I-746)+(1.019)+(1.087), (I-746)+(1.019)+(1.088), (I-746)+(1.019)+(1.089), (I-746)+(1.019)+(1.090), (I-746)+(1.019)+(1.091), (I-746)+(1.019)+(1.092), (I-746)+(1.019)+(2.001), (I-746)+(1.019)+(2.002), (I-746)+(1.019)+(2.003), (I-746)+(1.019)+(2.004), (I-746)+(1.019)+(2.005), (I-746)+(1.019)+(2.006), (I-746)+(1.019)+(2.007), (I-746)+(1.019)+(2.008), (I-746)+(1.019)+(2.009), (I-746)+(1.019)+(2.010), (I-746)+(1.019)+(2.011), (I-746)+(1.019)+(2.012), (I-746)+(1.019)+(2.013), (I-746)+(1.019)+(2.014), (I-746)+(1.019)+(2.015), (I-746)+(1.019)+(2.016), (I-746)+(1.019)+(2.017), (I-746)+(1.019)+(2.018), (I-746)+(1.019)+(2.019), (I-746)+(1.019)+(2.020), (I-746)+(1.019)+(2.021), (I-746)+(1.019)+(2.022), (I-746)+(1.019)+(2.023), (I-746)+(1.019)+(2.024), (I-746)+(1.019)+(2.025), (I-746)+(1.019)+(2.026), (I-746)+(1.019)+(2.027), (I-746)+(1.019)+(2.028), (I-746)+(1.019)+(2.029), (I-746)+(1.019)+(2.030), (I-746)+(1.019)+(2.031), (I-746)+(1.019)+(2.032), (I-746)+(1.019)+(2.033), (I-746)+(1.019)+(2.034), (I-746)+(1.019)+(2.035), (I-746)+(1.019)+(2.036), (I-746)+(1.019)+(2.037), (I-746)+(1.019)+(2.038), (I-746)+(1.019)+(2.039), (I-746)+(1.019)+(2.040), (I-746)+(1.019)+(2.041), (I-746)+(1.019)+(2.042), (I-746)+(1.019)+(2.043), (I-746)+(1.019)+(2.044), (I-746)+(1.019)+(2.045), (I-746)+(1.019)+(2.046), (I-746)+(1.019)+(2.047), (I-746)+(1.019)+(2.048), (I-746)+(1.019)+(2.049), (I-746)+(1.019)+(2.050), (I-746)+(1.019)+(2.051), (I-746)+(1.019)+(2.052), (I-746)+(1.019)+(2.053), (I-746)+(1.019)+(2.054), (I-746)+(1.019)+(2.055), (I-746)+(1.019)+(2.056), (I-746)+(1.019)+(2.057), (I-746)+(1.019)+(2.058), (I-746)+(1.019)+(2.059), (I-746)+(1.019)+(3.001), (I-746)+(1.019)+(3.002), (I-746)+(1.019)+(3.003), (I-746)+(1.019)+(3.004), (I-746)+(1.019)+(3.005), (I-746)+(1.019)+(3.006), (I-746)+(1.019)+(3.007), (I-746)+(1.019)+(3.008), (I-746)+(1.019)+(3.009), (I-746)+(1.019)+(3.010), (I-746)+(1.019)+(3.011), (I-746)+(1.019)+(3.012), (I-746)+(1.019)+(3.013), (I-746)+(1.019)+(3.014), (I-746)+(1.019)+(3.015), (I-746)+(1.019)+(3.016), (I-746)+(1.019)+(3.017), (I-746)+(1.019)+(3.018), (I-746)+(1.019)+(3.019), (I-746)+(1.019)+(3.020), (I-746)+(1.019)+(3.021), (I-746)+(1.019)+(3.022), (I-746)+(1.019)+(3.023), (I-746)+(1.019)+(3.024), (I-746)+(1.019)+(3.025), (I-746)+(1.019)+(3.026), (I-746)+(1.019)+(3.027), (I-746)+(1.019)+(3.028), (I-746)+(1.019)+(3.029), (I-746)+(1.019)+(3.030), (I-746)+(1.019)+(3.031), (I-746)+(1.019)+(5.001), (I-746)+(1.019)+(5.002), (I-746)+(1.019)+(5.003), (I-746)+(1.019)+(5.004), (I-746)+(1.019)+(5.005), (I-746)+(1.019)+(5.006), (I-746)+(1.019)+(5.007), (I-746)+(1.019)+(5.008), (I-746)+(1.019)+(5.009), (I-746)+(1.019)+(5.010), (I-746)+(1.019)+(5.011), (I-746)+(1.019)+(5.012), (I-746)+(1.019)+(5.013), (I-746)+(1.019)+(5.014), (I-746)+(1.019)+(5.015), (I-746)+(1.019)+(5.016), (I-746)+(1.019)+(5.017), (I-746)+(1.019)+(5.018), (I-746)+(1.019)+(5.019), (I-746)+(1.019)+(5.020), (I-746)+(1.019)+(5.021), (I-746)+(1.019)+(5.022), (I-746)+(1.019)+(5.023), (I-746)+(1.019)+(6.001), (I-746)+(1.019)+(6.002), (I-746)+(1.019)+(6.003), (I-746)+(1.019)+(6.004), (I-746)+(1.019)+(7.001), (I-746)+(1.019)+(7.002), (I-746)+(1.019)+(7.003), (I-746)+(1.019)+(7.004), (I-746)+(1.019)+(7.005), (I-746)+(1.019)+(7.006), (I-746)+(1.019)+(9.001), (I-746)+(1.019)+(9.002), (I-746)+(1.019)+(9.003), (I-746)+(1.019)+(9.004), (I-746)+(1.019)+(9.005), (I-746)+(1.019)+(9.006), (I-746)+(1.019)+(9.007), (I-746)+(1.019)+(9.008), (I-746)+(1.019)+(9.009), (I-746)+(1.019)+(14.001), (I-746)+(1.019)+(14.002), (I-746)+(1.019)+(15.008), (I-746)+(1.019)+(15.011), (I-746)+(1.019)+(15.012), (I-746)+(1.019)+(15.016), (I-746)+(1.019)+(15.025), (I-746)+(1.019)+(15.027), (I-746)+(1.019)+(15.047), (I-746)+(1.019)+(15.063), (I-746)+(1.019)+(15.064), (I-746)+(1.019)+(16.001), (I-746)+(1.019)+(16.002), (I-746)+(1.019)+(16.003), (I-746)+(1.019)+(16.004), (I-746)+(1.019)+(16.005), (I-746)+(1.019)+(16.006), (I-746)+(1.019)+(16.007), (I-746)+(1.019)+(16.008), (I-746)+(1.019)+(17.001), (I-746)+(1.019)+(17.002), (I-746)+(1.019)+(17.003), (I-746)+(1.019)+(17.004), (I-746)+(1.019)+(17.005), (I-746)+(1.019)+(17.006), (I-746)+(1.019)+(17.007), (I-746)+(1.019)+(17.008), (I-746)+(1.019)+(17.009), (I-746)+(1.019)+(17.010), (I-746)+(1.019)+(17.011), (I-746)+(1.019)+(17.012), (I-746)+(1.019)+(18.001),

(I-746)+(1.020)+(1.021), (I-746)+(1.020)+(1.022), (I-746)+(1.020)+(1.023), (I-746)+(1.020)+(1.024), (I-746)+(1.020)+(1.025), (I-746)+(1.020)+(1.026), (I-746)+(1.020)+(1.027), (I-746)+(1.020)+(1.028), (I-746)+(1.020)+(1.029), (I-746)+(1.020)+(1.030), (I-746)+(1.020)+(1.031), (I-746)+(1.020)+(1.032), (I-746)+(1.020)+(1.033), (I-746)+(1.020)+(1.034), (I-746)+(1.020)+(1.035), (I-746)+(1.020)+(1.036), (I-746)+(1.020)+(1.037), (I-746)+(1.020)+(1.038), (I-746)+(1.020)+(1.039), (I-746)+(1.020)+(1.040), (I-746)+(1.020)+(1.041), (I-746)+(1.020)+(1.042), (I-746)+(1.020)+(1.043), (I-746)+(1.020)+(1.044), (I-746)+(1.020)+(1.045), (I-746)+(1.020)+(1.046), (I-746)+(1.020)+(1.047), (I-746)+(1.020)+(1.048), (I-746)+(1.020)+(1.049), (I-746)+(1.020)+(1.050), (I-746)+(1.020)+(1.051), (I-746)+(1.020)+(1.052), (I-746)+(1.020)+(1.053), (I-746)+(1.020)+(1.054), (I-746)+(1.020)+(1.055), (I-746)+(1.020)+(1.056), (I-746)+(1.020)+(1.057), (I-746)+(1.020)+(1.058), (I-746)+(1.020)+(1.059), (I-746)+(1.020)+(1.060), (I-746)+(1.020)+(1.061), (I-746)+(1.020)+(1.062), (I-746)+(1.020)+(1.063), (I-746)+(1.020)+(1.064), (I-746)+(1.020)+(1.065), (I-746)+(1.020)+(1.066), (I-746)+(1.020)+(1.067), (I-746)+(1.020)+(1.068), (I-746)+(1.020)+(1.069), (I-746)+(1.020)+(1.070), (I-746)+(1.020)+(1.071), (I-746)+(1.020)+(1.072), (I-746)+(1.020)+(1.073), (I-746)+(1.020)+(1.074), (I-746)+(1.020)+(1.075), (I-746)+(1.020)+(1.076), (I-746)+(1.020)+(1.077), (I-746)+(1.020)+(1.078), (I-746)+(1.020)+(1.079), (I-746)+(1.020)+(1.080), (I-746)+(1.020)+(1.081), (I-746)+(1.020)+(1.082), (I-746)+(1.020)+(1.083), (I-746)+(1.020)+(1.084), (I-746)+(1.020)+(1.085), (I-746)+(1.020)+(1.086), (I-746)+(1.020)+(1.087), (I-746)+(1.020)+(1.088), (I-746)+(1.020)+(1.089), (I-746)+(1.020)+(1.090), (I-746)+(1.020)+(1.091), (I-746)+(1.020)+(1.092), (I-746)+(1.020)+(2.001), (I-746)+(1.020)+(2.002), (I-746)+(1.020)+(2.003), (I-746)+(1.020)+(2.004), (I-746)+(1.020)+(2.005), (I-746)+(1.020)+(2.006), (I-746)+(1.020)+(2.007), (I-746)+(1.020)+(2.008), (I-746)+(1.020)+(2.009), (I-746)+(1.020)+(2.010), (I-746)+(1.020)+(2.011), (I-746)+(1.020)+(2.012), (I-746)+(1.020)+(2.013), (I-746)+(1.020)+(2.014), (I-746)+(1.020)+(2.015), (I-746)+(1.020)+(2.016), (I-746)+(1.020)+(2.017), (I-746)+(1.020)+(2.018), (I-746)+(1.020)+(2.019), (I-746)+(1.020)+(2.020), (I-746)+(1.020)+(2.021), (I-746)+(1.020)+(2.022), (I-746)+(1.020)+(2.023), (I-746)+(1.020)+(2.024), (I-746)+(1.020)+(2.025), (I-746)+(1.020)+(2.026), (I-746)+(1.020)+(2.027), (I-746)+(1.020)+(2.028), (I-746)+(1.020)+(2.029), (I-746)+(1.020)+(2.030), (I-746)+(1.020)+(2.031), (I-746)+(1.020)+(2.032), (I-746)+(1.020)+(2.033), (I-746)+(1.020)+(2.034), (I-746)+(1.020)+(2.035), (I-746)+(1.020)+(2.036), (I-746)+(1.020)+(2.037), (I-746)+(1.020)+(2.038), (I-746)+(1.020)+(2.039), (I-746)+(1.020)+(2.040), (I-746)+(1.020)+(2.041), (I-746)+(1.020)+(2.042), (I-746)+(1.020)+(2.043), (I-746)+(1.020)+(2.044), (I-746)+(1.020)+(2.045), (I-746)+(1.020)+(2.046), (I-746)+(1.020)+(2.047), (I-746)+(1.020)+(2.048), (I-746)+(1.020)+(2.049), (I-746)+(1.020)+(2.050), (I-746)+(1.020)+(2.051), (I-746)+(1.020)+(2.052), (I-746)+(1.020)+(2.053), (I-746)+(1.020)+(2.054), (I-746)+(1.020)+(2.055), (I-746)+(1.020)+(2.056), (I-746)+(1.020)+(2.057), (I-746)+(1.020)+(2.058), (I-746)+(1.020)+(2.059), (I-746)+(1.020)+(3.001), (I-746)+(1.020)+(3.002), (I-746)+(1.020)+(3.003), (I-746)+(1.020)+(3.004), (I-746)+(1.020)+(3.005), (I-746)+(1.020)+(3.006), (I-746)+(1.020)+(3.007), (I-746)+(1.020)+(3.008), (I-746)+(1.020)+(3.009), (I-746)+(1.020)+(3.010), (I-746)+(1.020)+(3.011), (I-746)+(1.020)+(3.012), (I-746)+(1.020)+(3.013), (I-746)+(1.020)+(3.014), (I-746)+(1.020)+(3.015), (I-746)+(1.020)+(3.016), (I-746)+(1.020)+(3.017), (I-746)+(1.020)+(3.018), (I-746)+(1.020)+(3.019), (I-746)+(1.020)+(3.020), (I-746)+(1.020)+(3.021), (I-746)+(1.020)+(3.022), (I-746)+(1.020)+(3.023), (I-746)+(1.020)+(3.024), (I-746)+(1.020)+(3.025), (I-746)+(1.020)+(3.026), (I-746)+(1.020)+(3.027), (I-746)+(1.020)+(3.028), (I-746)+(1.020)+(3.029), (I-746)+(1.020)+(3.030), (I-746)+(1.020)+(3.031), (I-746)+(1.020)+(5.001), (I-746)+(1.020)+(5.002), (I-746)+(1.020)+(5.003), (I-746)+(1.020)+(5.004), (I-746)+(1.020)+(5.005), (I-746)+(1.020)+(5.006), (I-746)+(1.020)+(5.007), (I-746)+(1.020)+(5.008), (I-746)+(1.020)+(5.009), (I-746)+(1.020)+(5.010), (I-746)+(1.020)+(5.011), (I-746)+(1.020)+(5.012), (I-746)+(1.020)+(5.013), (I-746)+(1.020)+(5.014), (I-746)+(1.020)+(5.015), (I-746)+(1.020)+(5.016), (I-746)+(1.020)+(5.017), (I-746)+(1.020)+(5.018), (I-746)+(1.020)+(5.019), (I-746)+(1.020)+(5.020), (I-746)+(1.020)+(5.021), (I-746)+(1.020)+(5.022), (I-746)+(1.020)+(5.023), (I-746)+(1.020)+(6.001), (I-746)+(1.020)+(6.002), (I-746)+(1.020)+(6.003), (I-746)+(1.020)+(6.004), (I-746)+(1.020)+(7.001), (I-746)+(1.020)+(7.002), (I-746)+(1.020)+(7.003), (I-746)+(1.020)+(7.004), (I-746)+(1.020)+(7.005), (I-746)+(1.020)+(7.006), (I-746)+(1.020)+(9.001), (I-746)+(1.020)+(9.002), (I-746)+(1.020)+(9.003), (I-746)+(1.020)+(9.004), (I-746)+(1.020)+(9.005), (I-746)+(1.020)+(9.006), (I-746)+(1.020)+(9.007), (I-746)+(1.020)+(9.008), (I-746)+(1.020)+(9.009), (I-746)+(1.020)+(14.001), (I-746)+(1.020)+(14.002), (I-746)+(1.020)+(15.008), (I-746)+(1.020)+(15.011), (I-746)+(1.020)+(15.012), (I-746)+(1.020)+(15.016), (I-746)+(1.020)+(15.025), (I-746)+(1.020)+(15.027), (I-746)+(1.020)+(15.047), (I-746)+(1.020)+(15.063), (I-746)+(1.020)+(15.064), (I-746)+(1.020)+(16.001), (I-746)+(1.020)+(16.002), (I-746)+(1.020)+(16.003), (I-746)+(1.020)+(16.004), (I-746)+(1.020)+(16.005), (I-746)+(1.020)+(16.006), (I-746)+(1.020)+(16.007), (I-746)+(1.020)+(16.008), (I-746)+(1.020)+(17.001), (I-746)+(1.020)+(17.002), (I-746)+(1.020)+(17.003), (I-746)+(1.020)+(17.004), (I-746)+(1.020)+(17.005), (I-746)+(1.020)+(17.006), (I-746)+(1.020)+(17.007), (I-746)+(1.020)+(17.008), (I-746)+(1.020)+(17.009), (I-746)+(1.020)+(17.010), (I-746)+(1.020)+(17.011), (I-746)+(1.020)+(17.012), (I-746)+(1.020)+(18.001),

(I-746)+(1.021)+(1.022), (I-746)+(1.021)+(1.023), (I-746)+(1.021)+(1.024), (I-746)+(1.021)+(1.025), (I-746)+(1.021)+(1.026), (I-746)+(1.021)+(1.027), (I-746)+(1.021)+(1.028), (I-746)+(1.021)+(1.029), (I-746)+(1.021)+(1.030), (I-746)+(1.021)+(1.031), (I-746)+(1.021)+(1.032), (I-746)+(1.021)+(1.033), (I-746)+(1.021)+(1.034), (I-746)+(1.021)+(1.035), (I-746)+(1.021)+(1.036), (I-746)+(1.021)+(1.037), (I-746)+(1.021)+(1.038), (I-746)+(1.021)+(1.039), (I-746)+(1.021)+(1.040), (I-746)+(1.021)+(1.041), (I-746)+(1.021)+(1.042), (I-746)+(1.021)+(1.043), (I-746)+(1.021)+(1.044), (I-746)+(1.021)+(1.045), (I-746)+(1.021)+(1.046), (I-746)+(1.021)+(1.047), (I-746)+(1.021)+(1.048), (I-746)+(1.021)+(1.049), (I-746)+(1.021)+(1.050), (I-746)+(1.021)+(1.051), (I-746)+(1.021)+(1.052), (I-746)+(1.021)+(1.053), (I-746)+(1.021)+(1.054), (I-746)+(1.021)+(1.055), (I-746)+(1.021)+(1.056), (I-746)+(1.021)+(1.057), (I-746)+(1.021)+(1.058), (I-746)+(1.021)+(1.059), (I-746)+(1.021)+(1.060), (I-746)+(1.021)+(1.061), (I-746)+(1.021)+(1.062), (I-746)+(1.021)+(1.063), (I-746)+(1.021)+(1.064), (I-746)+(1.021)+(1.065), (I-746)+(1.021)+(1.066), (I-746)+(1.021)+(1.067), (I-746)+(1.021)+(1.068), (I-746)+(1.021)+(1.069), (I-746)+(1.021)+(1.070), (I-746)+(1.021)+(1.071), (I-746)+(1.021)+(1.072), (I-746)+(1.021)+(1.073), (I-746)+(1.021)+(1.074), (I-746)+(1.021)+(1.075), (I-746)+(1.021)+(1.076), (I-746)+(1.021)+(1.077), (I-746)+(1.021)+(1.078), (I-746)+(1.021)+(1.079), (I-746)+(1.021)+(1.080), (I-746)+(1.021)+(1.081), (I-746)+(1.021)+(1.082), (I-746)+(1.021)+(1.083), (I-746)+(1.021)+(1.084), (I-746)+(1.021)+(1.085), (I-746)+(1.021)+(1.086), (I-746)+(1.021)+(1.087), (I-746)+(1.021)+(1.088), (I-746)+(1.021)+(1.089), (I-746)+(1.021)+(1.090), (I-746)+(1.021)+(1.091), (I-746)+(1.021)+(1.092), (I-746)+(1.021)+(2.001), (I-746)+(1.021)+(2.002), (I-746)+(1.021)+(2.003), (I-746)+(1.021)+(2.004), (I-746)+(1.021)+(2.005), (I-746)+(1.021)+(2.006), (I-746)+(1.021)+(2.007), (I-746)+(1.021)+(2.008), (I-746)+(1.021)+(2.009), (I-746)+(1.021)+(2.010), (I-746)+(1.021)+(2.011), (I-746)+(1.021)+(2.012), (I-746)+(1.021)+(2.013), (I-746)+(1.021)+(2.014), (I-746)+(1.021)+(2.015), (I-746)+(1.021)+(2.016), (I-746)+(1.021)+(2.017), (I-746)+(1.021)+(2.018), (I-746)+(1.021)+(2.019), (I-746)+(1.021)+(2.020), (I-746)+(1.021)+(2.021), (I-746)+(1.021)+(2.022), (I-746)+(1.021)+(2.023), (I-746)+(1.021)+(2.024), (I-746)+(1.021)+(2.025), (I-746)+(1.021)+(2.026), (I-746)+(1.021)+(2.027), (I-746)+(1.021)+(2.028), (I-746)+(1.021)+(2.029), (I-746)+(1.021)+(2.030), (I-746)+(1.021)+(2.031), (I-746)+(1.021)+(2.032), (I-746)+(1.021)+(2.033), (I-746)+(1.021)+(2.034), (I-746)+(1.021)+(2.035), (I-746)+(1.021)+(2.036), (I-746)+(1.021)+(2.037), (I-746)+(1.021)+(2.038), (I-746)+(1.021)+(2.039), (I-746)+(1.021)+(2.040), (I-746)+(1.021)+(2.041), (I-746)+(1.021)+(2.042), (I-746)+(1.021)+(2.043), (I-746)+(1.021)+(2.044), (I-746)+(1.021)+(2.045), (I-746)+(1.021)+(2.046), (I-746)+(1.021)+(2.047), (I-746)+(1.021)+(2.048), (I-746)+(1.021)+(2.049), (I-746)+(1.021)+(2.050), (I-746)+(1.021)+(2.051), (I-746)+(1.021)+(2.052), (I-746)+(1.021)+(2.053), (I-746)+(1.021)+(2.054), (I-746)+(1.021)+(2.055), (I-746)+(1.021)+(2.056), (I-746)+(1.021)+(2.057), (I-746)+(1.021)+(2.058), (I-746)+(1.021)+(2.059), (I-746)+(1.021)+(3.001), (I-746)+(1.021)+(3.002), (I-746)+(1.021)+(3.003), (I-746)+(1.021)+(3.004), (I-746)+(1.021)+(3.005), (I-746)+(1.021)+(3.006), (I-746)+(1.021)+(3.007), (I-746)+(1.021)+(3.008), (I-746)+(1.021)+(3.009), (I-746)+(1.021)+(3.010), (I-746)+(1.021)+(3.011), (I-746)+(1.021)+(3.012), (I-746)+(1.021)+(3.013), (I-746)+(1.021)+(3.014), (I-746)+(1.021)+(3.015), (I-746)+(1.021)+(3.016), (I-746)+(1.021)+(3.017), (I-746)+(1.021)+(3.018), (I-746)+(1.021)+(3.019), (I-746)+(1.021)+(3.020), (I-746)+(1.021)+(3.021), (I-746)+(1.021)+(3.022), (I-746)+(1.021)+(3.023), (I-746)+(1.021)+(3.024), (I-746)+(1.021)+(3.025), (I-746)+(1.021)+(3.026), (I-746)+(1.021)+(3.027), (I-746)+(1.021)+(3.028), (I-746)+(1.021)+(3.029), (I-746)+(1.021)+(3.030), (I-746)+(1.021)+(3.031), (I-746)+(1.021)+(5.001), (I-746)+(1.021)+(5.002), (I-746)+(1.021)+(5.003), (I-746)+(1.021)+(5.004), (I-746)+(1.021)+(5.005), (I-746)+(1.021)+(5.006), (I-746)+(1.021)+(5.007), (I-746)+(1.021)+(5.008), (I-746)+(1.021)+(5.009), (I-746)+(1.021)+(5.010), (I-746)+(1.021)+(5.011), (I-746)+(1.021)+(5.012), (I-746)+(1.021)+(5.013), (I-746)+(1.021)+(5.014), (I-746)+(1.021)+(5.015), (I-746)+(1.021)+(5.016), (I-746)+(1.021)+(5.017), (I-746)+(1.021)+(5.018), (I-746)+(1.021)+(5.019), (I-746)+(1.021)+(5.020), (I-746)+(1.021)+(5.021), (I-746)+(1.021)+(5.022), (I-746)+(1.021)+(5.023), (I-746)+(1.021)+(6.001), (I-746)+(1.021)+(6.002), (I-746)+(1.021)+(6.003), (I-746)+(1.021)+(6.004), (I-746)+(1.021)+(7.001), (I-746)+(1.021)+(7.002), (I-746)+(1.021)+(7.003), (I-746)+(1.021)+(7.004), (I-746)+(1.021)+(7.005), (I-746)+(1.021)+(7.006), (I-746)+(1.021)+(9.001), (I-746)+(1.021)+(9.002), (I-746)+(1.021)+(9.003), (I-746)+(1.021)+(9.004), (I-746)+(1.021)+(9.005), (I-746)+(1.021)+(9.006), (I-746)+(1.021)+(9.007), (I-746)+(1.021)+(9.008), (I-746)+(1.021)+(9.009), (I-746)+(1.021)+(14.001), (I-746)+(1.021)+(14.002), (I-746)+(1.021)+(15.008), (I-746)+(1.021)+(15.011), (I-746)+(1.021)+(15.012), (I-746)+(1.021)+(15.016), (I-746)+(1.021)+(15.025), (I-746)+(1.021)+(15.027), (I-746)+(1.021)+(15.047), (I-746)+(1.021)+(15.063), (I-746)+(1.021)+(15.064), (I-746)+(1.021)+(16.001), (I-746)+(1.021)+(16.002), (I-746)+(1.021)+(16.003), (I-746)+(1.021)+(16.004), (I-746)+(1.021)+(16.005), (I-746)+(1.021)+(16.006), (I-746)+(1.021)+(16.007), (I-746)+(1.021)+(16.008), (I-746)+(1.021)+(17.001), (I-746)+(1.021)+(17.002), (I-746)+(1.021)+(17.003), (I-746)+(1.021)+(17.004), (I-746)+(1.021)+(17.005), (I-746)+(1.021)+(17.006), (I-746)+(1.021)+(17.007), (I-746)+(1.021)+(17.008), (I-746)+(1.021)+(17.009), (I-746)+(1.021)+(17.010), (I-746)+(1.021)+(17.011), (I-746)+(1.021)+(17.012), (I-746)+(1.021)+(18.001),

(I-746)+(1.022)+(1.023), (I-746)+(1.022)+(1.024), (I-746)+(1.022)+(1.025), (I-746)+(1.022)+(1.026), (I-746)+(1.022)+(1.027), (I-746)+(1.022)+(1.028), (I-746)+(1.022)+(1.029), (I-746)+(1.022)+(1.030), (I-746)+(1.022)+(1.031), (I-746)+(1.022)+(1.032), (I-746)+(1.022)+(1.033), (I-746)+(1.022)+(1.034), (I-746)+(1.022)+(1.035), (I-746)+(1.022)+(1.036), (I-746)+(1.022)+(1.037), (I-746)+(1.022)+(1.038), (I-746)+(1.022)+(1.039), (I-746)+(1.022)+(1.040), (I-746)+(1.022)+(1.041), (I-746)+(1.022)+(1.042), (I-746)+(1.022)+(1.043), (I-746)+(1.022)+(1.044), (I-746)+(1.022)+(1.045), (I-746)+(1.022)+(1.046), (I-746)+(1.022)+(1.047), (I-746)+(1.022)+(1.048), (I-746)+(1.022)+(1.049), (I-746)+(1.022)+(1.050), (I-746)+(1.022)+(1.051), (I-746)+(1.022)+(1.052), (I-746)+(1.022)+(1.053), (I-746)+(1.022)+(1.054), (I-746)+(1.022)+(1.055), (I-746)+(1.022)+(1.056), (I-746)+(1.022)+(1.057), (I-746)+(1.022)+(1.058), (I-746)+(1.022)+(1.059), (I-746)+(1.022)+(1.060), (I-746)+(1.022)+(1.061), (I-746)+(1.022)+(1.062), (I-746)+(1.022)+(1.063), (I-746)+(1.022)+(1.064), (I-746)+(1.022)+(1.065), (I-746)+(1.022)+(1.066), (I-746)+(1.022)+(1.067), (I-746)+(1.022)+(1.068), (I-746)+(1.022)+(1.069), (I-746)+(1.022)+(1.070), (I-746)+(1.022)+(1.071), (I-746)+(1.022)+(1.072), (I-746)+(1.022)+(1.073), (I-746)+(1.022)+(1.074), (I-746)+(1.022)+(1.075), (I-746)+(1.022)+(1.076), (I-746)+(1.022)+(1.077), (I-746)+(1.022)+(1.078), (I-746)+(1.022)+(1.079), (I-746)+(1.022)+(1.080), (I-746)+(1.022)+(1.081), (I-746)+(1.022)+(1.082), (I-746)+(1.022)+(1.083), (I-746)+(1.022)+(1.084), (I-746)+(1.022)+(1.085), (I-746)+(1.022)+(1.086), (I-746)+(1.022)+(1.087), (I-746)+(1.022)+(1.088), (I-746)+(1.022)+(1.089), (I-746)+(1.022)+(1.090), (I-746)+(1.022)+(1.091), (I-746)+(1.022)+(1.092), (I-746)+(1.022)+(2.001), (I-746)+(1.022)+(2.002), (I-746)+(1.022)+(2.003), (I-746)+(1.022)+(2.004), (I-746)+(1.022)+(2.005), (I-746)+(1.022)+(2.006), (I-746)+(1.022)+(2.007), (I-746)+(1.022)+(2.008), (I-746)+(1.022)+(2.009), (I-746)+(1.022)+(2.010), (I-746)+(1.022)+(2.011), (I-746)+(1.022)+(2.012), (I-746)+(1.022)+(2.013), (I-746)+(1.022)+(2.014), (I-746)+(1.022)+(2.015), (I-746)+(1.022)+(2.016), (I-746)+(1.022)+(2.017), (I-746)+(1.022)+(2.018), (I-746)+(1.022)+(2.019), (I-746)+(1.022)+(2.020), (I-746)+(1.022)+(2.021), (I-746)+(1.022)+(2.022), (I-746)+(1.022)+(2.023), (I-746)+(1.022)+(2.024), (I-746)+(1.022)+(2.025), (I-746)+(1.022)+(2.026), (I-746)+(1.022)+(2.027), (I-746)+(1.022)+(2.028), (I-746)+(1.022)+(2.029), (I-746)+(1.022)+(2.030), (I-746)+(1.022)+(2.031), (I-746)+(1.022)+(2.032), (I-746)+(1.022)+(2.033), (I-746)+(1.022)+(2.034), (I-746)+(1.022)+(2.035), (I-746)+(1.022)+(2.036), (I-746)+(1.022)+(2.037), (I-746)+(1.022)+(2.038), (I-746)+(1.022)+(2.039), (I-746)+(1.022)+(2.040), (I-746)+(1.022)+(2.041), (I-746)+(1.022)+(2.042), (I-746)+(1.022)+(2.043), (I-746)+(1.022)+(2.044), (I-746)+(1.022)+(2.045), (I-746)+(1.022)+(2.046), (I-746)+(1.022)+(2.047), (I-746)+(1.022)+(2.048), (I-746)+(1.022)+(2.049), (I-746)+(1.022)+(2.050), (I-746)+(1.022)+(2.051), (I-746)+(1.022)+(2.052), (I-746)+(1.022)+(2.053), (I-746)+(1.022)+(2.054), (I-746)+(1.022)+(2.055), (I-746)+(1.022)+(2.056), (I-746)+(1.022)+(2.057), (I-746)+(1.022)+(2.058), (I-746)+(1.022)+(2.059), (I-746)+(1.022)+(3.001), (I-746)+(1.022)+(3.002), (I-746)+(1.022)+(3.003), (I-746)+(1.022)+(3.004), (I-746)+(1.022)+(3.005), (I-746)+(1.022)+(3.006), (I-746)+(1.022)+(3.007), (I-746)+(1.022)+(3.008), (I-746)+(1.022)+(3.009), (I-746)+(1.022)+(3.010), (I-746)+(1.022)+(3.011), (I-746)+(1.022)+(3.012), (I-746)+(1.022)+(3.013), (I-746)+(1.022)+(3.014), (I-746)+(1.022)+(3.015), (I-746)+(1.022)+(3.016), (I-746)+(1.022)+(3.017), (I-746)+(1.022)+(3.018), (I-746)+(1.022)+(3.019), (I-746)+(1.022)+(3.020), (I-746)+(1.022)+(3.021), (I-746)+(1.022)+(3.022), (I-746)+(1.022)+(3.023), (I-746)+(1.022)+(3.024), (I-746)+(1.022)+(3.025), (I-746)+(1.022)+(3.026), (I-746)+(1.022)+(3.027), (I-746)+(1.022)+(3.028), (I-746)+(1.022)+(3.029), (I-746)+(1.022)+(3.030), (I-746)+(1.022)+(3.031), (I-746)+(1.022)+(5.001), (I-746)+(1.022)+(5.002), (I-746)+(1.022)+(5.003), (I-746)+(1.022)+(5.004), (I-746)+(1.022)+(5.005), (I-746)+(1.022)+(5.006), (I-746)+(1.022)+(5.007), (I-746)+(1.022)+(5.008), (I-746)+(1.022)+(5.009), (I-746)+(1.022)+(5.010), (I-746)+(1.022)+(5.011), (I-746)+(1.022)+(5.012), (I-746)+(1.022)+(5.013), (I-746)+(1.022)+(5.014), (I-746)+(1.022)+(5.015), (I-746)+(1.022)+(5.016), (I-746)+(1.022)+(5.017), (I-746)+(1.022)+(5.018), (I-746)+(1.022)+(5.019), (I-746)+(1.022)+(5.020), (I-746)+(1.022)+(5.021), (I-746)+(1.022)+(5.022), (I-746)+(1.022)+(5.023), (I-746)+(1.022)+(6.001), (I-746)+(1.022)+(6.002), (I-746)+(1.022)+(6.003), (I-746)+(1.022)+(6.004), (I-746)+(1.022)+(7.001), (I-746)+(1.022)+(7.002), (I-746)+(1.022)+(7.003), (I-746)+(1.022)+(7.004), (I-746)+(1.022)+(7.005), (I-746)+(1.022)+(7.006), (I-746)+(1.022)+(9.001), (I-746)+(1.022)+(9.002), (I-746)+(1.022)+(9.003), (I-746)+(1.022)+(9.004), (I-746)+(1.022)+(9.005), (I-746)+(1.022)+(9.006), (I-746)+(1.022)+(9.007), (I-746)+(1.022)+(9.008), (I-746)+(1.022)+(9.009), (I-746)+(1.022)+(14.001), (I-746)+(1.022)+(14.002), (I-746)+(1.022)+(15.008), (I-746)+(1.022)+(15.011), (I-746)+(1.022)+(15.012), (I-746)+(1.022)+(15.016), (I-746)+(1.022)+(15.025), (I-746)+(1.022)+(15.027), (I-746)+(1.022)+(15.047), (I-746)+(1.022)+(15.063), (I-746)+(1.022)+(15.064), (I-746)+(1.022)+(16.001), (I-746)+(1.022)+(16.002), (I-746)+(1.022)+(16.003), (I-746)+(1.022)+(16.004), (I-746)+(1.022)+(16.005), (I-746)+(1.022)+(16.006), (I-746)+(1.022)+(16.007), (I-746)+(1.022)+(16.008), (I-746)+(1.022)+(17.001), (I-746)+(1.022)+(17.002), (I-746)+(1.022)+(17.003), (I-746)+(1.022)+(17.004), (I-746)+(1.022)+(17.005), (I-746)+(1.022)+(17.006), (I-746)+(1.022)+(17.007), (I-746)+(1.022)+(17.008), (I-746)+(1.022)+(17.009), (I-746)+(1.022)+(17.010), (I-746)+(1.022)+(17.011), (I-746)+(1.022)+(17.012), (I-746)+(1.022)+(18.001),

(I-746)+(1.023)+(1.024), (I-746)+(1.023)+(1.025), (I-746)+(1.023)+(1.026), (I-746)+(1.023)+(1.027), (I-746)+(1.023)+(1.028), (I-746)+(1.023)+(1.029), (I-746)+(1.023)+(1.030), (I-746)+(1.023)+(1.031), (I-746)+(1.023)+(1.032), (I-746)+(1.023)+(1.033), (I-746)+(1.023)+(1.034), (I-746)+(1.023)+(1.035), (I-746)+(1.023)+(1.036), (I-746)+(1.023)+(1.037), (I-746)+(1.023)+(1.038), (I-746)+(1.023)+(1.039), (I-746)+(1.023)+(1.040), (I-746)+(1.023)+(1.041), (I-746)+(1.023)+(1.042), (I-746)+(1.023)+(1.043), (I-746)+(1.023)+(1.044), (I-746)+(1.023)+(1.045), (I-746)+(1.023)+(1.046), (I-746)+(1.023)+(1.047), (I-746)+(1.023)+(1.048), (I-746)+(1.023)+(1.049), (I-746)+(1.023)+(1.050), (I-746)+(1.023)+(1.051), (I-746)+(1.023)+(1.052), (I-746)+(1.023)+(1.053), (I-746)+(1.023)+(1.054), (I-746)+(1.023)+(1.055), (I-746)+(1.023)+(1.056), (I-746)+(1.023)+(1.057), (I-746)+(1.023)+(1.058), (I-746)+(1.023)+(1.059), (I-746)+(1.023)+(1.060), (I-746)+(1.023)+(1.061), (I-746)+(1.023)+(1.062), (I-746)+(1.023)+(1.063), (I-746)+(1.023)+(1.064), (I-746)+(1.023)+(1.065), (I-746)+(1.023)+(1.066), (I-746)+(1.023)+(1.067), (I-746)+(1.023)+(1.068), (I-746)+(1.023)+(1.069), (I-746)+(1.023)+(1.070), (I-746)+(1.023)+(1.071), (I-746)+(1.023)+(1.072), (I-746)+(1.023)+(1.073), (I-746)+(1.023)+(1.074), (I-746)+(1.023)+(1.075), (I-746)+(1.023)+(1.076), (I-746)+(1.023)+(1.077), (I-746)+(1.023)+(1.078), (I-746)+(1.023)+(1.079), (I-746)+(1.023)+(1.080), (I-746)+(1.023)+(1.081), (I-746)+(1.023)+(1.082), (I-746)+(1.023)+(1.083), (I-746)+(1.023)+(1.084), (I-746)+(1.023)+(1.085), (I-746)+(1.023)+(1.086), (I-746)+(1.023)+(1.087), (I-746)+(1.023)+(1.088), (I-746)+(1.023)+(1.089), (I-746)+(1.023)+(1.090), (I-746)+(1.023)+(1.091), (I-746)+(1.023)+(1.092), (I-746)+(1.023)+(2.001), (I-746)+(1.023)+(2.002), (I-746)+(1.023)+(2.003), (I-746)+(1.023)+(2.004), (I-746)+(1.023)+(2.005), (I-746)+(1.023)+(2.006), (I-746)+(1.023)+(2.007), (I-746)+(1.023)+(2.008), (I-746)+(1.023)+(2.009), (I-746)+(1.023)+(2.010), (I-746)+(1.023)+(2.011), (I-746)+(1.023)+(2.012), (I-746)+(1.023)+(2.013), (I-746)+(1.023)+(2.014), (I-746)+(1.023)+(2.015), (I-746)+(1.023)+(2.016), (I-746)+(1.023)+(2.017), (I-746)+(1.023)+(2.018), (I-746)+(1.023)+(2.019), (I-746)+(1.023)+(2.020), (I-746)+(1.023)+(2.021), (I-746)+(1.023)+(2.022), (I-746)+(1.023)+(2.023), (I-746)+(1.023)+(2.024), (I-746)+(1.023)+(2.025), (I-746)+(1.023)+(2.026), (I-746)+(1.023)+(2.027), (I-746)+(1.023)+(2.028), (I-746)+(1.023)+(2.029), (I-746)+(1.023)+(2.030), (I-746)+(1.023)+(2.031), (I-746)+(1.023)+(2.032), (I-746)+(1.023)+(2.033), (I-746)+(1.023)+(2.034), (I-746)+(1.023)+(2.035), (I-746)+(1.023)+(2.036), (I-746)+(1.023)+(2.037), (I-746)+(1.023)+(2.038), (I-746)+(1.023)+(2.039), (I-746)+(1.023)+(2.040), (I-746)+(1.023)+(2.041), (I-746)+(1.023)+(2.042), (I-746)+(1.023)+(2.043), (I-746)+(1.023)+(2.044), (I-746)+(1.023)+(2.045), (I-746)+(1.023)+(2.046), (I-746)+(1.023)+(2.047), (I-746)+(1.023)+(2.048), (I-746)+(1.023)+(2.049), (I-746)+(1.023)+(2.050), (I-746)+(1.023)+(2.051), (I-746)+(1.023)+(2.052), (I-746)+(1.023)+(2.053), (I-746)+(1.023)+(2.054), (I-746)+(1.023)+(2.055), (I-746)+(1.023)+(2.056), (I-746)+(1.023)+(2.057), (I-746)+(1.023)+(2.058), (I-746)+(1.023)+(2.059), (I-746)+(1.023)+(3.001), (I-746)+(1.023)+(3.002), (I-746)+(1.023)+(3.003), (I-746)+(1.023)+(3.004), (I-746)+(1.023)+(3.005), (I-746)+(1.023)+(3.006), (I-746)+(1.023)+(3.007), (I-746)+(1.023)+(3.008), (I-746)+(1.023)+(3.009), (I-746)+(1.023)+(3.010), (I-746)+(1.023)+(3.011), (I-746)+(1.023)+(3.012), (I-746)+(1.023)+(3.013), (I-746)+(1.023)+(3.014), (I-746)+(1.023)+(3.015), (I-746)+(1.023)+(3.016), (I-746)+(1.023)+(3.017), (I-746)+(1.023)+(3.018), (I-746)+(1.023)+(3.019), (I-746)+(1.023)+(3.020), (I-746)+(1.023)+(3.021), (I-746)+(1.023)+(3.022), (I-746)+(1.023)+(3.023), (I-746)+(1.023)+(3.024), (I-746)+(1.023)+(3.025), (I-746)+(1.023)+(3.026), (I-746)+(1.023)+(3.027), (I-746)+(1.023)+(3.028), (I-746)+(1.023)+(3.029), (I-746)+(1.023)+(3.030), (I-746)+(1.023)+(3.031), (I-746)+(1.023)+(5.001), (I-746)+(1.023)+(5.002), (I-746)+(1.023)+(5.003), (I-746)+(1.023)+(5.004), (I-746)+(1.023)+(5.005), (I-746)+(1.023)+(5.006), (I-746)+(1.023)+(5.007), (I-746)+(1.023)+(5.008), (I-746)+(1.023)+(5.009), (I-746)+(1.023)+(5.010), (I-746)+(1.023)+(5.011), (I-746)+(1.023)+(5.012), (I-746)+(1.023)+(5.013), (I-746)+(1.023)+(5.014), (I-746)+(1.023)+(5.015), (I-746)+(1.023)+(5.016), (I-746)+(1.023)+(5.017), (I-746)+(1.023)+(5.018), (I-746)+(1.023)+(5.019), (I-746)+(1.023)+(5.020), (I-746)+(1.023)+(5.021), (I-746)+(1.023)+(5.022), (I-746)+(1.023)+(5.023), (I-746)+(1.023)+(6.001), (I-746)+(1.023)+(6.002), (I-746)+(1.023)+(6.003), (I-746)+(1.023)+(6.004), (I-746)+(1.023)+(7.001), (I-746)+(1.023)+(7.002), (I-746)+(1.023)+(7.003), (I-746)+(1.023)+(7.004), (I-746)+(1.023)+(7.005), (I-746)+(1.023)+(7.006), (I-746)+(1.023)+(9.001), (I-746)+(1.023)+(9.002), (I-746)+(1.023)+(9.003), (I-746)+(1.023)+(9.004), (I-746)+(1.023)+(9.005), (I-746)+(1.023)+(9.006), (I-746)+(1.023)+(9.007), (I-746)+(1.023)+(9.008), (I-746)+(1.023)+(9.009), (I-746)+(1.023)+(14.001), (I-746)+(1.023)+(14.002), (I-746)+(1.023)+(15.008), (I-746)+(1.023)+(15.011), (I-746)+(1.023)+(15.012), (I-746)+(1.023)+(15.016), (I-746)+(1.023)+(15.025), (I-746)+(1.023)+(15.027), (I-746)+(1.023)+(15.047), (I-746)+(1.023)+(15.063), (I-746)+(1.023)+(15.064), (I-746)+(1.023)+(16.001), (I-746)+(1.023)+(16.002), (I-746)+(1.023)+(16.003), (I-746)+(1.023)+(16.004), (I-746)+(1.023)+(16.005), (I-746)+(1.023)+(16.006), (I-746)+(1.023)+(16.007), (I-746)+(1.023)+(16.008), (I-746)+(1.023)+(17.001), (I-746)+(1.023)+(17.002), (I-746)+(1.023)+(17.003), (I-746)+(1.023)+(17.004), (I-746)+(1.023)+(17.005), (I-746)+(1.023)+(17.006), (I-746)+(1.023)+(17.007), (I-746)+(1.023)+(17.008), (I-746)+(1.023)+(17.009), (I-746)+(1.023)+(17.010), (I-746)+(1.023)+(17.011), (I-746)+(1.023)+(17.012), (I-746)+(1.023)+(18.001),

(I-746)+(1.024)+(1.025), (I-746)+(1.024)+(1.026), (I-746)+(1.024)+(1.027), (I-746)+(1.024)+(1.028), (I-746)+(1.024)+(1.029), (I-746)+(1.024)+(1.030), (I-746)+(1.024)+(1.031), (I-746)+(1.024)+(1.032), (I-746)+(1.024)+(1.033), (I-746)+(1.024)+(1.034), (I-746)+(1.024)+(1.035), (I-746)+(1.024)+(1.036), (I-746)+(1.024)+(1.037), (I-746)+(1.024)+(1.038), (I-746)+(1.024)+(1.039), (I-746)+(1.024)+(1.040), (I-746)+(1.024)+(1.041), (I-746)+(1.024)+(1.042), (I-746)+(1.024)+(1.043), (I-746)+(1.024)+(1.044), (I-746)+(1.024)+(1.045), (I-746)+(1.024)+(1.046), (I-746)+(1.024)+(1.047), (I-746)+(1.024)+(1.048), (I-746)+(1.024)+(1.049), (I-746)+(1.024)+(1.050), (I-746)+(1.024)+(1.051), (I-746)+(1.024)+(1.052), (I-746)+(1.024)+(1.053), (I-746)+(1.024)+(1.054), (I-746)+(1.024)+(1.055), (I-746)+(1.024)+(1.056), (I-746)+(1.024)+(1.057), (I-746)+(1.024)+(1.058), (I-746)+(1.024)+(1.059), (I-746)+(1.024)+(1.060), (I-746)+(1.024)+(1.061), (I-746)+(1.024)+(1.062), (I-746)+(1.024)+(1.063), (I-746)+(1.024)+(1.064), (I-746)+(1.024)+(1.065), (I-746)+(1.024)+(1.066), (I-746)+(1.024)+(1.067), (I-746)+(1.024)+(1.068), (I-746)+(1.024)+(1.069), (I-746)+(1.024)+(1.070), (I-746)+(1.024)+(1.071), (I-746)+(1.024)+(1.072), (I-746)+(1.024)+(1.073), (I-746)+(1.024)+(1.074), (I-746)+(1.024)+(1.075), (I-746)+(1.024)+(1.076), (I-746)+(1.024)+(1.077), (I-746)+(1.024)+(1.078), (I-746)+(1.024)+(1.079), (I-746)+(1.024)+(1.080), (I-746)+(1.024)+(1.081), (I-746)+(1.024)+(1.082), (I-746)+(1.024)+(1.083), (I-746)+(1.024)+(1.084), (I-746)+(1.024)+(1.085), (I-746)+(1.024)+(1.086), (I-746)+(1.024)+(1.087), (I-746)+(1.024)+(1.088), (I-746)+(1.024)+(1.089), (I-746)+(1.024)+(1.090), (I-746)+(1.024)+(1.091), (I-746)+(1.024)+(1.092), (I-746)+(1.024)+(2.001), (I-746)+(1.024)+(2.002), (I-746)+(1.024)+(2.003), (I-746)+(1.024)+(2.004), (I-746)+(1.024)+(2.005), (I-746)+(1.024)+(2.006), (I-746)+(1.024)+(2.007), (I-746)+(1.024)+(2.008), (I-746)+(1.024)+(2.009), (I-746)+(1.024)+(2.010), (I-746)+(1.024)+(2.011), (I-746)+(1.024)+(2.012), (I-746)+(1.024)+(2.013), (I-746)+(1.024)+(2.014), (I-746)+(1.024)+(2.015), (I-746)+(1.024)+(2.016), (I-746)+(1.024)+(2.017), (I-746)+(1.024)+(2.018), (I-746)+(1.024)+(2.019), (I-746)+(1.024)+(2.020), (I-746)+(1.024)+(2.021), (I-746)+(1.024)+(2.022), (I-746)+(1.024)+(2.023), (I-746)+(1.024)+(2.024), (I-746)+(1.024)+(2.025), (I-746)+(1.024)+(2.026), (I-746)+(1.024)+(2.027), (I-746)+(1.024)+(2.028), (I-746)+(1.024)+(2.029), (I-746)+(1.024)+(2.030), (I-746)+(1.024)+(2.031), (I-746)+(1.024)+(2.032), (I-746)+(1.024)+(2.033), (I-746)+(1.024)+(2.034), (I-746)+(1.024)+(2.035), (I-746)+(1.024)+(2.036), (I-746)+(1.024)+(2.037), (I-746)+(1.024)+(2.038), (I-746)+(1.024)+(2.039), (I-746)+(1.024)+(2.040), (I-746)+(1.024)+(2.041), (I-746)+(1.024)+(2.042), (I-746)+(1.024)+(2.043), (I-746)+(1.024)+(2.044), (I-746)+(1.024)+(2.045), (I-746)+(1.024)+(2.046), (I-746)+(1.024)+(2.047), (I-746)+(1.024)+(2.048), (I-746)+(1.024)+(2.049), (I-746)+(1.024)+(2.050), (I-746)+(1.024)+(2.051), (I-746)+(1.024)+(2.052), (I-746)+(1.024)+(2.053), (I-746)+(1.024)+(2.054), (I-746)+(1.024)+(2.055), (I-746)+(1.024)+(2.056), (I-746)+(1.024)+(2.057), (I-746)+(1.024)+(2.058), (I-746)+(1.024)+(2.059), (I-746)+(1.024)+(3.001), (I-746)+(1.024)+(3.002), (I-746)+(1.024)+(3.003), (I-746)+(1.024)+(3.004), (I-746)+(1.024)+(3.005), (I-746)+(1.024)+(3.006), (I-746)+(1.024)+(3.007), (I-746)+(1.024)+(3.008), (I-746)+(1.024)+(3.009), (I-746)+(1.024)+(3.010), (I-746)+(1.024)+(3.011), (I-746)+(1.024)+(3.012), (I-746)+(1.024)+(3.013), (I-746)+(1.024)+(3.014), (I-746)+(1.024)+(3.015), (I-746)+(1.024)+(3.016), (I-746)+(1.024)+(3.017), (I-746)+(1.024)+(3.018), (I-746)+(1.024)+(3.019), (I-746)+(1.024)+(3.020), (I-746)+(1.024)+(3.021), (I-746)+(1.024)+(3.022), (I-746)+(1.024)+(3.023), (I-746)+(1.024)+(3.024), (I-746)+(1.024)+(3.025), (I-746)+(1.024)+(3.026), (I-746)+(1.024)+(3.027), (I-746)+(1.024)+(3.028), (I-746)+(1.024)+(3.029), (I-746)+(1.024)+(3.030), (I-746)+(1.024)+(3.031), (I-746)+(1.024)+(5.001), (I-746)+(1.024)+(5.002), (I-746)+(1.024)+(5.003), (I-746)+(1.024)+(5.004), (I-746)+(1.024)+(5.005), (I-746)+(1.024)+(5.006), (I-746)+(1.024)+(5.007), (I-746)+(1.024)+(5.008), (I-746)+(1.024)+(5.009), (I-746)+(1.024)+(5.010), (I-746)+(1.024)+(5.011), (I-746)+(1.024)+(5.012), (I-746)+(1.024)+(5.013), (I-746)+(1.024)+(5.014), (I-746)+(1.024)+(5.015), (I-746)+(1.024)+(5.016), (I-746)+(1.024)+(5.017), (I-746)+(1.024)+(5.018), (I-746)+(1.024)+(5.019), (I-746)+(1.024)+(5.020), (I-746)+(1.024)+(5.021), (I-746)+(1.024)+(5.022), (I-746)+(1.024)+(5.023), (I-746)+(1.024)+(6.001), (I-746)+(1.024)+(6.002), (I-746)+(1.024)+(6.003), (I-746)+(1.024)+(6.004), (I-746)+(1.024)+(7.001), (I-746)+(1.024)+(7.002), (I-746)+(1.024)+(7.003), (I-746)+(1.024)+(7.004), (I-746)+(1.024)+(7.005), (I-746)+(1.024)+(7.006), (I-746)+(1.024)+(9.001), (I-746)+(1.024)+(9.002), (I-746)+(1.024)+(9.003), (I-746)+(1.024)+(9.004), (I-746)+(1.024)+(9.005), (I-746)+(1.024)+(9.006), (I-746)+(1.024)+(9.007), (I-746)+(1.024)+(9.008), (I-746)+(1.024)+(9.009), (I-746)+(1.024)+(14.001), (I-746)+(1.024)+(14.002), (I-746)+(1.024)+(15.008), (I-746)+(1.024)+(15.011), (I-746)+(1.024)+(15.012), (I-746)+(1.024)+(15.016), (I-746)+(1.024)+(15.025), (I-746)+(1.024)+(15.027), (I-746)+(1.024)+(15.047), (I-746)+(1.024)+(15.063), (I-746)+(1.024)+(15.064), (I-746)+(1.024)+(16.001), (I-746)+(1.024)+(16.002), (I-746)+(1.024)+(16.003), (I-746)+(1.024)+(16.004), (I-746)+(1.024)+(16.005), (I-746)+(1.024)+(16.006), (I-746)+(1.024)+(16.007), (I-746)+(1.024)+(16.008), (I-746)+(1.024)+(17.001), (I-746)+(1.024)+(17.002), (I-746)+(1.024)+(17.003), (I-746)+(1.024)+(17.004), (I-746)+(1.024)+(17.005), (I-746)+(1.024)+(17.006), (I-746)+(1.024)+(17.007), (I-746)+(1.024)+(17.008), (I-746)+(1.024)+(17.009), (I-746)+(1.024)+(17.010), (I-746)+(1.024)+(17.011), (I-746)+(1.024)+(17.012), (I-746)+(1.024)+(18.001),

(I-746)+(1.025)+(1.026), (I-746)+(1.025)+(1.027), (I-746)+(1.025)+(1.028), (I-746)+(1.025)+(1.029), (I-746)+(1.025)+(1.030), (I-746)+(1.025)+(1.031), (I-746)+(1.025)+(1.032), (I-746)+(1.025)+(1.033), (I-746)+(1.025)+(1.034), (I-746)+(1.025)+(1.035), (I-746)+(1.025)+(1.036), (I-746)+(1.025)+(1.037), (I-746)+(1.025)+(1.038), (I-746)+(1.025)+(1.039), (I-746)+(1.025)+(1.040), (I-746)+(1.025)+(1.041), (I-746)+(1.025)+(1.042), (I-746)+(1.025)+(1.043), (I-746)+(1.025)+(1.044), (I-746)+(1.025)+(1.045), (I-746)+(1.025)+(1.046), (I-746)+(1.025)+(1.047), (I-746)+(1.025)+(1.048), (I-746)+(1.025)+(1.049), (I-746)+(1.025)+(1.050), (I-746)+(1.025)+(1.051), (I-746)+(1.025)+(1.052), (I-746)+(1.025)+(1.053), (I-746)+(1.025)+(1.054), (I-746)+(1.025)+(1.055), (I-746)+(1.025)+(1.056), (I-746)+(1.025)+(1.057), (I-746)+(1.025)+(1.058), (I-746)+(1.025)+(1.059), (I-746)+(1.025)+(1.060), (I-746)+(1.025)+(1.061), (I-746)+(1.025)+(1.062), (I-746)+(1.025)+(1.063), (I-746)+(1.025)+(1.064), (I-746)+(1.025)+(1.065), (I-746)+(1.025)+(1.066), (I-746)+(1.025)+(1.067), (I-746)+(1.025)+(1.068), (I-746)+(1.025)+(1.069), (I-746)+(1.025)+(1.070), (I-746)+(1.025)+(1.071), (I-746)+(1.025)+(1.072), (I-746)+(1.025)+(1.073), (I-746)+(1.025)+(1.074), (I-746)+(1.025)+(1.075), (I-746)+(1.025)+(1.076), (I-746)+(1.025)+(1.077), (I-746)+(1.025)+(1.078), (I-746)+(1.025)+(1.079), (I-746)+(1.025)+(1.080), (I-746)+(1.025)+(1.081), (I-746)+(1.025)+(1.082), (I-746)+(1.025)+(1.083), (I-746)+(1.025)+(1.084), (I-746)+(1.025)+(1.085), (I-746)+(1.025)+(1.086), (I-746)+(1.025)+(1.087), (I-746)+(1.025)+(1.088), (I-746)+(1.025)+(1.089), (I-746)+(1.025)+(1.090), (I-746)+(1.025)+(1.091), (I-746)+(1.025)+(1.092), (I-746)+(1.025)+(2.001), (I-746)+(1.025)+(2.002), (I-746)+(1.025)+(2.003), (I-746)+(1.025)+(2.004), (I-746)+(1.025)+(2.005), (I-746)+(1.025)+(2.006), (I-746)+(1.025)+(2.007), (I-746)+(1.025)+(2.008), (I-746)+(1.025)+(2.009), (I-746)+(1.025)+(2.010), (I-746)+(1.025)+(2.011), (I-746)+(1.025)+(2.012), (I-746)+(1.025)+(2.013), (I-746)+(1.025)+(2.014), (I-746)+(1.025)+(2.015), (I-746)+(1.025)+(2.016), (I-746)+(1.025)+(2.017), (I-746)+(1.025)+(2.018), (I-746)+(1.025)+(2.019), (I-746)+(1.025)+(2.020), (I-746)+(1.025)+(2.021), (I-746)+(1.025)+(2.022), (I-746)+(1.025)+(2.023), (I-746)+(1.025)+(2.024), (I-746)+(1.025)+(2.025), (I-746)+(1.025)+(2.026), (I-746)+(1.025)+(2.027), (I-746)+(1.025)+(2.028), (I-746)+(1.025)+(2.029), (I-746)+(1.025)+(2.030), (I-746)+(1.025)+(2.031), (I-746)+(1.025)+(2.032), (I-746)+(1.025)+(2.033), (I-746)+(1.025)+(2.034), (I-746)+(1.025)+(2.035), (I-746)+(1.025)+(2.036), (I-746)+(1.025)+(2.037), (I-746)+(1.025)+(2.038), (I-746)+(1.025)+(2.039), (I-746)+(1.025)+(2.040), (I-746)+(1.025)+(2.041), (I-746)+(1.025)+(2.042), (I-746)+(1.025)+(2.043), (I-746)+(1.025)+(2.044), (I-746)+(1.025)+(2.045), (I-746)+(1.025)+(2.046), (I-746)+(1.025)+(2.047), (I-746)+(1.025)+(2.048), (I-746)+(1.025)+(2.049), (I-746)+(1.025)+(2.050), (I-746)+(1.025)+(2.051), (I-746)+(1.025)+(2.052), (I-746)+(1.025)+(2.053), (I-746)+(1.025)+(2.054), (I-746)+(1.025)+(2.055), (I-746)+(1.025)+(2.056), (I-746)+(1.025)+(2.057), (I-746)+(1.025)+(2.058), (I-746)+(1.025)+(2.059), (I-746)+(1.025)+(3.001), (I-746)+(1.025)+(3.002), (I-746)+(1.025)+(3.003), (I-746)+(1.025)+(3.004), (I-746)+(1.025)+(3.005), (I-746)+(1.025)+(3.006), (I-746)+(1.025)+(3.007), (I-746)+(1.025)+(3.008), (I-746)+(1.025)+(3.009), (I-746)+(1.025)+(3.010), (I-746)+(1.025)+(3.011), (I-746)+(1.025)+(3.012), (I-746)+(1.025)+(3.013), (I-746)+(1.025)+(3.014), (I-746)+(1.025)+(3.015), (I-746)+(1.025)+(3.016), (I-746)+(1.025)+(3.017), (I-746)+(1.025)+(3.018), (I-746)+(1.025)+(3.019), (I-746)+(1.025)+(3.020), (I-746)+(1.025)+(3.021), (I-746)+(1.025)+(3.022), (I-746)+(1.025)+(3.023), (I-746)+(1.025)+(3.024), (I-746)+(1.025)+(3.025), (I-746)+(1.025)+(3.026), (I-746)+(1.025)+(3.027), (I-746)+(1.025)+(3.028), (I-746)+(1.025)+(3.029), (I-746)+(1.025)+(3.030), (I-746)+(1.025)+(3.031), (I-746)+(1.025)+(5.001), (I-746)+(1.025)+(5.002), (I-746)+(1.025)+(5.003), (I-746)+(1.025)+(5.004), (I-746)+(1.025)+(5.005), (I-746)+(1.025)+(5.006), (I-746)+(1.025)+(5.007), (I-746)+(1.025)+(5.008), (I-746)+(1.025)+(5.009), (I-746)+(1.025)+(5.010), (I-746)+(1.025)+(5.011), (I-746)+(1.025)+(5.012), (I-746)+(1.025)+(5.013), (I-746)+(1.025)+(5.014), (I-746)+(1.025)+(5.015), (I-746)+(1.025)+(5.016), (I-746)+(1.025)+(5.017), (I-746)+(1.025)+(5.018), (I-746)+(1.025)+(5.019), (I-746)+(1.025)+(5.020), (I-746)+(1.025)+(5.021), (I-746)+(1.025)+(5.022), (I-746)+(1.025)+(5.023), (I-746)+(1.025)+(6.001), (I-746)+(1.025)+(6.002), (I-746)+(1.025)+(6.003), (I-746)+(1.025)+(6.004), (I-746)+(1.025)+(7.001), (I-746)+(1.025)+(7.002), (I-746)+(1.025)+(7.003), (I-746)+(1.025)+(7.004), (I-746)+(1.025)+(7.005), (I-746)+(1.025)+(7.006), (I-746)+(1.025)+(9.001), (I-746)+(1.025)+(9.002), (I-746)+(1.025)+(9.003), (I-746)+(1.025)+(9.004), (I-746)+(1.025)+(9.005), (I-746)+(1.025)+(9.006), (I-746)+(1.025)+(9.007), (I-746)+(1.025)+(9.008), (I-746)+(1.025)+(9.009), (I-746)+(1.025)+(14.001), (I-746)+(1.025)+(14.002), (I-746)+(1.025)+(15.008), (I-746)+(1.025)+(15.011), (I-746)+(1.025)+(15.012), (I-746)+(1.025)+(15.016), (I-746)+(1.025)+(15.025), (I-746)+(1.025)+(15.027), (I-746)+(1.025)+(15.047), (I-746)+(1.025)+(15.063), (I-746)+(1.025)+(15.064), (I-746)+(1.025)+(16.001), (I-746)+(1.025)+(16.002), (I-746)+(1.025)+(16.003), (I-746)+(1.025)+(16.004), (I-746)+(1.025)+(16.005), (I-746)+(1.025)+(16.006), (I-746)+(1.025)+(16.007), (I-746)+(1.025)+(16.008), (I-746)+(1.025)+(17.001), (I-746)+(1.025)+(17.002), (I-746)+(1.025)+(17.003), (I-746)+(1.025)+(17.004), (I-746)+(1.025)+(17.005), (I-746)+(1.025)+(17.006), (I-746)+(1.025)+(17.007), (I-746)+(1.025)+(17.008), (I-746)+(1.025)+(17.009), (I-746)+(1.025)+(17.010), (I-746)+(1.025)+(17.011), (I-746)+(1.025)+(17.012), (I-746)+(1.025)+(18.001),

(I-746)+(1.026)+(1.027), (I-746)+(1.026)+(1.028), (I-746)+(1.026)+(1.029), (I-746)+(1.026)+(1.030), (I-746)+(1.026)+(1.031), (I-746)+(1.026)+(1.032), (I-746)+(1.026)+(1.033), (I-746)+(1.026)+(1.034), (I-746)+(1.026)+(1.035), (I-746)+(1.026)+(1.036), (I-746)+(1.026)+(1.037), (I-746)+(1.026)+(1.038), (I-746)+(1.026)+(1.039), (I-746)+(1.026)+(1.040), (I-746)+(1.026)+(1.041), (I-746)+(1.026)+(1.042), (I-746)+(1.026)+(1.043), (I-746)+(1.026)+(1.044), (I-746)+(1.026)+(1.045), (I-746)+(1.026)+(1.046), (I-746)+(1.026)+(1.047), (I-746)+(1.026)+(1.048), (I-746)+(1.026)+(1.049), (I-746)+(1.026)+(1.050), (I-746)+(1.026)+(1.051), (I-746)+(1.026)+(1.052), (I-746)+(1.026)+(1.053), (I-746)+(1.026)+(1.054), (I-746)+(1.026)+(1.055), (I-746)+(1.026)+(1.056), (I-746)+(1.026)+(1.057), (I-746)+(1.026)+(1.058), (I-746)+(1.026)+(1.059), (I-746)+(1.026)+(1.060), (I-746)+(1.026)+(1.061), (I-746)+(1.026)+(1.062), (I-746)+(1.026)+(1.063), (I-746)+(1.026)+(1.064), (I-746)+(1.026)+(1.065), (I-746)+(1.026)+(1.066), (I-746)+(1.026)+(1.067), (I-746)+(1.026)+(1.068), (I-746)+(1.026)+(1.069), (I-746)+(1.026)+(1.070), (I-746)+(1.026)+(1.071), (I-746)+(1.026)+(1.072), (I-746)+(1.026)+(1.073), (I-746)+(1.026)+(1.074), (I-746)+(1.026)+(1.075), (I-746)+(1.026)+(1.076), (I-746)+(1.026)+(1.077), (I-746)+(1.026)+(1.078), (I-746)+(1.026)+(1.079), (I-746)+(1.026)+(1.080), (I-746)+(1.026)+(1.081), (I-746)+(1.026)+(1.082), (I-746)+(1.026)+(1.083), (I-746)+(1.026)+(1.084), (I-746)+(1.026)+(1.085), (I-746)+(1.026)+(1.086), (I-746)+(1.026)+(1.087), (I-746)+(1.026)+(1.088), (I-746)+(1.026)+(1.089), (I-746)+(1.026)+(1.090), (I-746)+(1.026)+(1.091), (I-746)+(1.026)+(1.092), (I-746)+(1.026)+(2.001), (I-746)+(1.026)+(2.002), (I-746)+(1.026)+(2.003), (I-746)+(1.026)+(2.004), (I-746)+(1.026)+(2.005), (I-746)+(1.026)+(2.006), (I-746)+(1.026)+(2.007), (I-746)+(1.026)+(2.008), (I-746)+(1.026)+(2.009), (I-746)+(1.026)+(2.010), (I-746)+(1.026)+(2.011), (I-746)+(1.026)+(2.012), (I-746)+(1.026)+(2.013), (I-746)+(1.026)+(2.014), (I-746)+(1.026)+(2.015), (I-746)+(1.026)+(2.016), (I-746)+(1.026)+(2.017), (I-746)+(1.026)+(2.018), (I-746)+(1.026)+(2.019), (I-746)+(1.026)+(2.020), (I-746)+(1.026)+(2.021), (I-746)+(1.026)+(2.022), (I-746)+(1.026)+(2.023), (I-746)+(1.026)+(2.024), (I-746)+(1.026)+(2.025), (I-746)+(1.026)+(2.026), (I-746)+(1.026)+(2.027), (I-746)+(1.026)+(2.028), (I-746)+(1.026)+(2.029), (I-746)+(1.026)+(2.030), (I-746)+(1.026)+(2.031), (I-746)+(1.026)+(2.032), (I-746)+(1.026)+(2.033), (I-746)+(1.026)+(2.034), (I-746)+(1.026)+(2.035), (I-746)+(1.026)+(2.036), (I-746)+(1.026)+(2.037), (I-746)+(1.026)+(2.038), (I-746)+(1.026)+(2.039), (I-746)+(1.026)+(2.040), (I-746)+(1.026)+(2.041), (I-746)+(1.026)+(2.042), (I-746)+(1.026)+(2.043), (I-746)+(1.026)+(2.044), (I-746)+(1.026)+(2.045), (I-746)+(1.026)+(2.046), (I-746)+(1.026)+(2.047), (I-746)+(1.026)+(2.048), (I-746)+(1.026)+(2.049), (I-746)+(1.026)+(2.050), (I-746)+(1.026)+(2.051), (I-746)+(1.026)+(2.052), (I-746)+(1.026)+(2.053), (I-746)+(1.026)+(2.054), (I-746)+(1.026)+(2.055), (I-746)+(1.026)+(2.056), (I-746)+(1.026)+(2.057), (I-746)+(1.026)+(2.058), (I-746)+(1.026)+(2.059), (I-746)+(1.026)+(3.001), (I-746)+(1.026)+(3.002), (I-746)+(1.026)+(3.003), (I-746)+(1.026)+(3.004), (I-746)+(1.026)+(3.005), (I-746)+(1.026)+(3.006), (I-746)+(1.026)+(3.007), (I-746)+(1.026)+(3.008), (I-746)+(1.026)+(3.009), (I-746)+(1.026)+(3.010), (I-746)+(1.026)+(3.011), (I-746)+(1.026)+(3.012), (I-746)+(1.026)+(3.013), (I-746)+(1.026)+(3.014), (I-746)+(1.026)+(3.015), (I-746)+(1.026)+(3.016), (I-746)+(1.026)+(3.017), (I-746)+(1.026)+(3.018), (I-746)+(1.026)+(3.019), (I-746)+(1.026)+(3.020), (I-746)+(1.026)+(3.021), (I-746)+(1.026)+(3.022), (I-746)+(1.026)+(3.023), (I-746)+(1.026)+(3.024), (I-746)+(1.026)+(3.025), (I-746)+(1.026)+(3.026), (I-746)+(1.026)+(3.027), (I-746)+(1.026)+(3.028), (I-746)+(1.026)+(3.029), (I-746)+(1.026)+(3.030), (I-746)+(1.026)+(3.031), (I-746)+(1.026)+(5.001), (I-746)+(1.026)+(5.002), (I-746)+(1.026)+(5.003), (I-746)+(1.026)+(5.004), (I-746)+(1.026)+(5.005), (I-746)+(1.026)+(5.006), (I-746)+(1.026)+(5.007), (I-746)+(1.026)+(5.008), (I-746)+(1.026)+(5.009), (I-746)+(1.026)+(5.010), (I-746)+(1.026)+(5.011), (I-746)+(1.026)+(5.012), (I-746)+(1.026)+(5.013), (I-746)+(1.026)+(5.014), (I-746)+(1.026)+(5.015), (I-746)+(1.026)+(5.016), (I-746)+(1.026)+(5.017), (I-746)+(1.026)+(5.018), (I-746)+(1.026)+(5.019), (I-746)+(1.026)+(5.020), (I-746)+(1.026)+(5.021), (I-746)+(1.026)+(5.022), (I-746)+(1.026)+(5.023), (I-746)+(1.026)+(6.001), (I-746)+(1.026)+(6.002), (I-746)+(1.026)+(6.003), (I-746)+(1.026)+(6.004), (I-746)+(1.026)+(7.001), (I-746)+(1.026)+(7.002), (I-746)+(1.026)+(7.003), (I-746)+(1.026)+(7.004), (I-746)+(1.026)+(7.005), (I-746)+(1.026)+(7.006), (I-746)+(1.026)+(9.001), (I-746)+(1.026)+(9.002), (I-746)+(1.026)+(9.003), (I-746)+(1.026)+(9.004), (I-746)+(1.026)+(9.005), (I-746)+(1.026)+(9.006), (I-746)+(1.026)+(9.007), (I-746)+(1.026)+(9.008), (I-746)+(1.026)+(9.009), (I-746)+(1.026)+(14.001), (I-746)+(1.026)+(14.002), (I-746)+(1.026)+(15.008), (I-746)+(1.026)+(15.011), (I-746)+(1.026)+(15.012), (I-746)+(1.026)+(15.016), (I-746)+(1.026)+(15.025), (I-746)+(1.026)+(15.027), (I-746)+(1.026)+(15.047), (I-746)+(1.026)+(15.063), (I-746)+(1.026)+(15.064), (I-746)+(1.026)+(16.001), (I-746)+(1.026)+(16.002), (I-746)+(1.026)+(16.003), (I-746)+(1.026)+(16.004), (I-746)+(1.026)+(16.005), (I-746)+(1.026)+(16.006), (I-746)+(1.026)+(16.007), (I-746)+(1.026)+(16.008), (I-746)+(1.026)+(17.001), (I-746)+(1.026)+(17.002), (I-746)+(1.026)+(17.003), (I-746)+(1.026)+(17.004), (I-746)+(1.026)+(17.005), (I-746)+(1.026)+(17.006), (I-746)+(1.026)+(17.007), (I-746)+(1.026)+(17.008), (I-746)+(1.026)+(17.009), (I-746)+(1.026)+(17.010), (I-746)+(1.026)+(17.011), (I-746)+(1.026)+(17.012), (I-746)+(1.026)+(18.001),

(I-746)+(1.027)+(1.028), (I-746)+(1.027)+(1.029), (I-746)+(1.027)+(1.030), (I-746)+(1.027)+(1.031), (I-746)+(1.027)+(1.032), (I-746)+(1.027)+(1.033), (I-746)+(1.027)+(1.034), (I-746)+(1.027)+(1.035), (I-746)+(1.027)+(1.036), (I-746)+(1.027)+(1.037), (I-746)+(1.027)+(1.038), (I-746)+(1.027)+(1.039), (I-746)+(1.027)+(1.040), (I-746)+(1.027)+(1.041), (I-746)+(1.027)+(1.042), (I-746)+(1.027)+(1.043), (I-746)+(1.027)+(1.044), (I-746)+(1.027)+(1.045), (I-746)+(1.027)+(1.046), (I-746)+(1.027)+(1.047), (I-746)+(1.027)+(1.048), (I-746)+(1.027)+(1.049), (I-746)+(1.027)+(1.050), (I-746)+(1.027)+(1.051), (I-746)+(1.027)+(1.052), (I-746)+(1.027)+(1.053), (I-746)+(1.027)+(1.054), (I-746)+(1.027)+(1.055), (I-746)+(1.027)+(1.056), (I-746)+(1.027)+(1.057), (I-746)+(1.027)+(1.058), (I-746)+(1.027)+(1.059), (I-746)+(1.027)+(1.060), (I-746)+(1.027)+(1.061), (I-746)+(1.027)+(1.062), (I-746)+(1.027)+(1.063), (I-746)+(1.027)+(1.064), (I-746)+(1.027)+(1.065), (I-746)+(1.027)+(1.066), (I-746)+(1.027)+(1.067), (I-746)+(1.027)+(1.068), (I-746)+(1.027)+(1.069), (I-746)+(1.027)+(1.070), (I-746)+(1.027)+(1.071), (I-746)+(1.027)+(1.072), (I-746)+(1.027)+(1.073), (I-746)+(1.027)+(1.074), (I-746)+(1.027)+(1.075), (I-746)+(1.027)+(1.076), (I-746)+(1.027)+(1.077), (I-746)+(1.027)+(1.078), (I-746)+(1.027)+(1.079), (I-746)+(1.027)+(1.080), (I-746)+(1.027)+(1.081), (I-746)+(1.027)+(1.082), (I-746)+(1.027)+(1.083), (I-746)+(1.027)+(1.084), (I-746)+(1.027)+(1.085), (I-746)+(1.027)+(1.086), (I-746)+(1.027)+(1.087), (I-746)+(1.027)+(1.088), (I-746)+(1.027)+(1.089), (I-746)+(1.027)+(1.090), (I-746)+(1.027)+(1.091), (I-746)+(1.027)+(1.092), (I-746)+(1.027)+(2.001), (I-746)+(1.027)+(2.002), (I-746)+(1.027)+(2.003), (I-746)+(1.027)+(2.004), (I-746)+(1.027)+(2.005), (I-746)+(1.027)+(2.006), (I-746)+(1.027)+(2.007), (I-746)+(1.027)+(2.008), (I-746)+(1.027)+(2.009), (I-746)+(1.027)+(2.010), (I-746)+(1.027)+(2.011), (I-746)+(1.027)+(2.012), (I-746)+(1.027)+(2.013), (I-746)+(1.027)+(2.014), (I-746)+(1.027)+(2.015), (I-746)+(1.027)+(2.016), (I-746)+(1.027)+(2.017), (I-746)+(1.027)+(2.018), (I-746)+(1.027)+(2.019), (I-746)+(1.027)+(2.020), (I-746)+(1.027)+(2.021), (I-746)+(1.027)+(2.022), (I-746)+(1.027)+(2.023), (I-746)+(1.027)+(2.024), (I-746)+(1.027)+(2.025), (I-746)+(1.027)+(2.026), (I-746)+(1.027)+(2.027), (I-746)+(1.027)+(2.028), (I-746)+(1.027)+(2.029), (I-746)+(1.027)+(2.030), (I-746)+(1.027)+(2.031), (I-746)+(1.027)+(2.032), (I-746)+(1.027)+(2.033), (I-746)+(1.027)+(2.034), (I-746)+(1.027)+(2.035), (I-746)+(1.027)+(2.036), (I-746)+(1.027)+(2.037), (I-746)+(1.027)+(2.038), (I-746)+(1.027)+(2.039), (I-746)+(1.027)+(2.040), (I-746)+(1.027)+(2.041), (I-746)+(1.027)+(2.042), (I-746)+(1.027)+(2.043), (I-746)+(1.027)+(2.044), (I-746)+(1.027)+(2.045), (I-746)+(1.027)+(2.046), (I-746)+(1.027)+(2.047), (I-746)+(1.027)+(2.048), (I-746)+(1.027)+(2.049), (I-746)+(1.027)+(2.050), (I-746)+(1.027)+(2.051), (I-746)+(1.027)+(2.052), (I-746)+(1.027)+(2.053), (I-746)+(1.027)+(2.054), (I-746)+(1.027)+(2.055), (I-746)+(1.027)+(2.056), (I-746)+(1.027)+(2.057), (I-746)+(1.027)+(2.058), (I-746)+(1.027)+(2.059), (I-746)+(1.027)+(3.001), (I-746)+(1.027)+(3.002), (I-746)+(1.027)+(3.003), (I-746)+(1.027)+(3.004), (I-746)+(1.027)+(3.005), (I-746)+(1.027)+(3.006), (I-746)+(1.027)+(3.007), (I-746)+(1.027)+(3.008), (I-746)+(1.027)+(3.009), (I-746)+(1.027)+(3.010), (I-746)+(1.027)+(3.011), (I-746)+(1.027)+(3.012), (I-746)+(1.027)+(3.013), (I-746)+(1.027)+(3.014), (I-746)+(1.027)+(3.015), (I-746)+(1.027)+(3.016), (I-746)+(1.027)+(3.017), (I-746)+(1.027)+(3.018), (I-746)+(1.027)+(3.019), (I-746)+(1.027)+(3.020), (I-746)+(1.027)+(3.021), (I-746)+(1.027)+(3.022), (I-746)+(1.027)+(3.023), (I-746)+(1.027)+(3.024), (I-746)+(1.027)+(3.025), (I-746)+(1.027)+(3.026), (I-746)+(1.027)+(3.027), (I-746)+(1.027)+(3.028), (I-746)+(1.027)+(3.029), (I-746)+(1.027)+(3.030), (I-746)+(1.027)+(3.031), (I-746)+(1.027)+(5.001), (I-746)+(1.027)+(5.002), (I-746)+(1.027)+(5.003), (I-746)+(1.027)+(5.004), (I-746)+(1.027)+(5.005), (I-746)+(1.027)+(5.006), (I-746)+(1.027)+(5.007), (I-746)+(1.027)+(5.008), (I-746)+(1.027)+(5.009), (I-746)+(1.027)+(5.010), (I-746)+(1.027)+(5.011), (I-746)+(1.027)+(5.012), (I-746)+(1.027)+(5.013), (I-746)+(1.027)+(5.014), (I-746)+(1.027)+(5.015), (I-746)+(1.027)+(5.016), (I-746)+(1.027)+(5.017), (I-746)+(1.027)+(5.018), (I-746)+(1.027)+(5.019), (I-746)+(1.027)+(5.020), (I-746)+(1.027)+(5.021), (I-746)+(1.027)+(5.022), (I-746)+(1.027)+(5.023), (I-746)+(1.027)+(6.001), (I-746)+(1.027)+(6.002), (I-746)+(1.027)+(6.003), (I-746)+(1.027)+(6.004), (I-746)+(1.027)+(7.001), (I-746)+(1.027)+(7.002), (I-746)+(1.027)+(7.003), (I-746)+(1.027)+(7.004), (I-746)+(1.027)+(7.005), (I-746)+(1.027)+(7.006), (I-746)+(1.027)+(9.001), (I-746)+(1.027)+(9.002), (I-746)+(1.027)+(9.003), (I-746)+(1.027)+(9.004), (I-746)+(1.027)+(9.005), (I-746)+(1.027)+(9.006), (I-746)+(1.027)+(9.007), (I-746)+(1.027)+(9.008), (I-746)+(1.027)+(9.009), (I-746)+(1.027)+(14.001), (I-746)+(1.027)+(14.002), (I-746)+(1.027)+(15.008), (I-746)+(1.027)+(15.011), (I-746)+(1.027)+(15.012), (I-746)+(1.027)+(15.016), (I-746)+(1.027)+(15.025), (I-746)+(1.027)+(15.027), (I-746)+(1.027)+(15.047), (I-746)+(1.027)+(15.063), (I-746)+(1.027)+(15.064), (I-746)+(1.027)+(16.001), (I-746)+(1.027)+(16.002), (I-746)+(1.027)+(16.003), (I-746)+(1.027)+(16.004), (I-746)+(1.027)+(16.005), (I-746)+(1.027)+(16.006), (I-746)+(1.027)+(16.007), (I-746)+(1.027)+(16.008), (I-746)+(1.027)+(17.001), (I-746)+(1.027)+(17.002), (I-746)+(1.027)+(17.003), (I-746)+(1.027)+(17.004), (I-746)+(1.027)+(17.005), (I-746)+(1.027)+(17.006), (I-746)+(1.027)+(17.007), (I-746)+(1.027)+(17.008), (I-746)+(1.027)+(17.009), (I-746)+(1.027)+(17.010), (I-746)+(1.027)+(17.011), (I-746)+(1.027)+(17.012), (I-746)+(1.027)+(18.001),

(I-746)+(1.028)+(1.029), (I-746)+(1.028)+(1.030), (I-746)+(1.028)+(1.031), (I-746)+(1.028)+(1.032), (I-746)+(1.028)+(1.033), (I-746)+(1.028)+(1.034), (I-746)+(1.028)+(1.035), (I-746)+(1.028)+(1.036), (I-746)+(1.028)+(1.037), (I-746)+(1.028)+(1.038), (I-746)+(1.028)+(1.039), (I-746)+(1.028)+(1.040), (I-746)+(1.028)+(1.041), (I-746)+(1.028)+(1.042), (I-746)+(1.028)+(1.043), (I-746)+(1.028)+(1.044), (I-746)+(1.028)+(1.045), (I-746)+(1.028)+(1.046), (I-746)+(1.028)+(1.047), (I-746)+(1.028)+(1.048), (I-746)+(1.028)+(1.049), (I-746)+(1.028)+(1.050), (I-746)+(1.028)+(1.051), (I-746)+(1.028)+(1.052), (I-746)+(1.028)+(1.053), (I-746)+(1.028)+(1.054), (I-746)+(1.028)+(1.055), (I-746)+(1.028)+(1.056), (I-746)+(1.028)+(1.057), (I-746)+(1.028)+(1.058), (I-746)+(1.028)+(1.059), (I-746)+(1.028)+(1.060), (I-746)+(1.028)+(1.061), (I-746)+(1.028)+(1.062), (I-746)+(1.028)+(1.063), (I-746)+(1.028)+(1.064), (I-746)+(1.028)+(1.065), (I-746)+(1.028)+(1.066), (I-746)+(1.028)+(1.067), (I-746)+(1.028)+(1.068), (I-746)+(1.028)+(1.069), (I-746)+(1.028)+(1.070), (I-746)+(1.028)+(1.071), (I-746)+(1.028)+(1.072), (I-746)+(1.028)+(1.073), (I-746)+(1.028)+(1.074), (I-746)+(1.028)+(1.075), (I-746)+(1.028)+(1.076), (I-746)+(1.028)+(1.077), (I-746)+(1.028)+(1.078), (I-746)+(1.028)+(1.079), (I-746)+(1.028)+(1.080), (I-746)+(1.028)+(1.081), (I-746)+(1.028)+(1.082), (I-746)+(1.028)+(1.083), (I-746)+(1.028)+(1.084), (I-746)+(1.028)+(1.085), (I-746)+(1.028)+(1.086), (I-746)+(1.028)+(1.087), (I-746)+(1.028)+(1.088), (I-746)+(1.028)+(1.089), (I-746)+(1.028)+(1.090), (I-746)+(1.028)+(1.091), (I-746)+(1.028)+(1.092), (I-746)+(1.028)+(2.001), (I-746)+(1.028)+(2.002), (I-746)+(1.028)+(2.003), (I-746)+(1.028)+(2.004), (I-746)+(1.028)+(2.005), (I-746)+(1.028)+(2.006), (I-746)+(1.028)+(2.007), (I-746)+(1.028)+(2.008), (I-746)+(1.028)+(2.009), (I-746)+(1.028)+(2.010), (I-746)+(1.028)+(2.011), (I-746)+(1.028)+(2.012), (I-746)+(1.028)+(2.013), (I-746)+(1.028)+(2.014), (I-746)+(1.028)+(2.015), (I-746)+(1.028)+(2.016), (I-746)+(1.028)+(2.017), (I-746)+(1.028)+(2.018), (I-746)+(1.028)+(2.019), (I-746)+(1.028)+(2.020), (I-746)+(1.028)+(2.021), (I-746)+(1.028)+(2.022), (I-746)+(1.028)+(2.023), (I-746)+(1.028)+(2.024), (I-746)+(1.028)+(2.025), (I-746)+(1.028)+(2.026), (I-746)+(1.028)+(2.027), (I-746)+(1.028)+(2.028), (I-746)+(1.028)+(2.029), (I-746)+(1.028)+(2.030), (I-746)+(1.028)+(2.031), (I-746)+(1.028)+(2.032), (I-746)+(1.028)+(2.033), (I-746)+(1.028)+(2.034), (I-746)+(1.028)+(2.035), (I-746)+(1.028)+(2.036), (I-746)+(1.028)+(2.037), (I-746)+(1.028)+(2.038), (I-746)+(1.028)+(2.039), (I-746)+(1.028)+(2.040), (I-746)+(1.028)+(2.041), (I-746)+(1.028)+(2.042), (I-746)+(1.028)+(2.043), (I-746)+(1.028)+(2.044), (I-746)+(1.028)+(2.045), (I-746)+(1.028)+(2.046), (I-746)+(1.028)+(2.047), (I-746)+(1.028)+(2.048), (I-746)+(1.028)+(2.049), (I-746)+(1.028)+(2.050), (I-746)+(1.028)+(2.051), (I-746)+(1.028)+(2.052), (I-746)+(1.028)+(2.053), (I-746)+(1.028)+(2.054), (I-746)+(1.028)+(2.055), (I-746)+(1.028)+(2.056), (I-746)+(1.028)+(2.057), (I-746)+(1.028)+(2.058), (I-746)+(1.028)+(2.059), (I-746)+(1.028)+(3.001), (I-746)+(1.028)+(3.002), (I-746)+(1.028)+(3.003), (I-746)+(1.028)+(3.004), (I-746)+(1.028)+(3.005), (I-746)+(1.028)+(3.006), (I-746)+(1.028)+(3.007), (I-746)+(1.028)+(3.008), (I-746)+(1.028)+(3.009), (I-746)+(1.028)+(3.010), (I-746)+(1.028)+(3.011), (I-746)+(1.028)+(3.012), (I-746)+(1.028)+(3.013), (I-746)+(1.028)+(3.014), (I-746)+(1.028)+(3.015), (I-746)+(1.028)+(3.016), (I-746)+(1.028)+(3.017), (I-746)+(1.028)+(3.018), (I-746)+(1.028)+(3.019), (I-746)+(1.028)+(3.020), (I-746)+(1.028)+(3.021), (I-746)+(1.028)+(3.022), (I-746)+(1.028)+(3.023), (I-746)+(1.028)+(3.024), (I-746)+(1.028)+(3.025), (I-746)+(1.028)+(3.026), (I-746)+(1.028)+(3.027), (I-746)+(1.028)+(3.028), (I-746)+(1.028)+(3.029), (I-746)+(1.028)+(3.030), (I-746)+(1.028)+(3.031), (I-746)+(1.028)+(5.001), (I-746)+(1.028)+(5.002), (I-746)+(1.028)+(5.003), (I-746)+(1.028)+(5.004), (I-746)+(1.028)+(5.005), (I-746)+(1.028)+(5.006), (I-746)+(1.028)+(5.007), (I-746)+(1.028)+(5.008), (I-746)+(1.028)+(5.009), (I-746)+(1.028)+(5.010), (I-746)+(1.028)+(5.011), (I-746)+(1.028)+(5.012), (I-746)+(1.028)+(5.013), (I-746)+(1.028)+(5.014), (I-746)+(1.028)+(5.015), (I-746)+(1.028)+(5.016), (I-746)+(1.028)+(5.017), (I-746)+(1.028)+(5.018), (I-746)+(1.028)+(5.019), (I-746)+(1.028)+(5.020), (I-746)+(1.028)+(5.021), (I-746)+(1.028)+(5.022), (I-746)+(1.028)+(5.023), (I-746)+(1.028)+(6.001), (I-746)+(1.028)+(6.002), (I-746)+(1.028)+(6.003), (I-746)+(1.028)+(6.004), (I-746)+(1.028)+(7.001), (I-746)+(1.028)+(7.002), (I-746)+(1.028)+(7.003), (I-746)+(1.028)+(7.004), (I-746)+(1.028)+(7.005), (I-746)+(1.028)+(7.006), (I-746)+(1.028)+(9.001), (I-746)+(1.028)+(9.002), (I-746)+(1.028)+(9.003), (I-746)+(1.028)+(9.004), (I-746)+(1.028)+(9.005), (I-746)+(1.028)+(9.006), (I-746)+(1.028)+(9.007), (I-746)+(1.028)+(9.008), (I-746)+(1.028)+(9.009), (I-746)+(1.028)+(14.001), (I-746)+(1.028)+(14.002), (I-746)+(1.028)+(15.008), (I-746)+(1.028)+(15.011), (I-746)+(1.028)+(15.012), (I-746)+(1.028)+(15.016), (I-746)+(1.028)+(15.025), (I-746)+(1.028)+(15.027), (I-746)+(1.028)+(15.047), (I-746)+(1.028)+(15.063), (I-746)+(1.028)+(15.064), (I-746)+(1.028)+(16.001), (I-746)+(1.028)+(16.002), (I-746)+(1.028)+(16.003), (I-746)+(1.028)+(16.004), (I-746)+(1.028)+(16.005), (I-746)+(1.028)+(16.006), (I-746)+(1.028)+(16.007), (I-746)+(1.028)+(16.008), (I-746)+(1.028)+(17.001), (I-746)+(1.028)+(17.002), (I-746)+(1.028)+(17.003), (I-746)+(1.028)+(17.004), (I-746)+(1.028)+(17.005), (I-746)+(1.028)+(17.006), (I-746)+(1.028)+(17.007), (I-746)+(1.028)+(17.008), (I-746)+(1.028)+(17.009), (I-746)+(1.028)+(17.010), (I-746)+(1.028)+(17.011), (I-746)+(1.028)+(17.012), (I-746)+(1.028)+(18.001),

(I-746)+(1.029)+(1.030), (I-746)+(1.029)+(1.031), (I-746)+(1.029)+(1.032), (I-746)+(1.029)+(1.033), (I-746)+(1.029)+(1.034), (I-746)+(1.029)+(1.035), (I-746)+(1.029)+(1.036), (I-746)+(1.029)+(1.037), (I-746)+(1.029)+(1.038), (I-746)+(1.029)+(1.039), (I-746)+(1.029)+(1.040), (I-746)+(1.029)+(1.041), (I-746)+(1.029)+(1.042), (I-746)+(1.029)+(1.043), (I-746)+(1.029)+(1.044), (I-746)+(1.029)+(1.045), (I-746)+(1.029)+(1.046), (I-746)+(1.029)+(1.047), (I-746)+(1.029)+(1.048), (I-746)+(1.029)+(1.049), (I-746)+(1.029)+(1.050), (I-746)+(1.029)+(1.051), (I-746)+(1.029)+(1.052), (I-746)+(1.029)+(1.053), (I-746)+(1.029)+(1.054), (I-746)+(1.029)+(1.055), (I-746)+(1.029)+(1.056), (I-746)+(1.029)+(1.057), (I-746)+(1.029)+(1.058), (I-746)+(1.029)+(1.059), (I-746)+(1.029)+(1.060), (I-746)+(1.029)+(1.061), (I-746)+(1.029)+(1.062), (I-746)+(1.029)+(1.063), (I-746)+(1.029)+(1.064), (I-746)+(1.029)+(1.065), (I-746)+(1.029)+(1.066), (I-746)+(1.029)+(1.067), (I-746)+(1.029)+(1.068), (I-746)+(1.029)+(1.069), (I-746)+(1.029)+(1.070), (I-746)+(1.029)+(1.071), (I-746)+(1.029)+(1.072), (I-746)+(1.029)+(1.073), (I-746)+(1.029)+(1.074), (I-746)+(1.029)+(1.075), (I-746)+(1.029)+(1.076), (I-746)+(1.029)+(1.077), (I-746)+(1.029)+(1.078), (I-746)+(1.029)+(1.079), (I-746)+(1.029)+(1.080), (I-746)+(1.029)+(1.081), (I-746)+(1.029)+(1.082), (I-746)+(1.029)+(1.083), (I-746)+(1.029)+(1.084), (I-746)+(1.029)+(1.085), (I-746)+(1.029)+(1.086), (I-746)+(1.029)+(1.087), (I-746)+(1.029)+(1.088), (I-746)+(1.029)+(1.089), (I-746)+(1.029)+(1.090), (I-746)+(1.029)+(1.091), (I-746)+(1.029)+(1.092), (I-746)+(1.029)+(2.001), (I-746)+(1.029)+(2.002), (I-746)+(1.029)+(2.003), (I-746)+(1.029)+(2.004), (I-746)+(1.029)+(2.005), (I-746)+(1.029)+(2.006), (I-746)+(1.029)+(2.007), (I-746)+(1.029)+(2.008), (I-746)+(1.029)+(2.009), (I-746)+(1.029)+(2.010), (I-746)+(1.029)+(2.011), (I-746)+(1.029)+(2.012), (I-746)+(1.029)+(2.013), (I-746)+(1.029)+(2.014), (I-746)+(1.029)+(2.015), (I-746)+(1.029)+(2.016), (I-746)+(1.029)+(2.017), (I-746)+(1.029)+(2.018), (I-746)+(1.029)+(2.019), (I-746)+(1.029)+(2.020), (I-746)+(1.029)+(2.021), (I-746)+(1.029)+(2.022), (I-746)+(1.029)+(2.023), (I-746)+(1.029)+(2.024), (I-746)+(1.029)+(2.025), (I-746)+(1.029)+(2.026), (I-746)+(1.029)+(2.027), (I-746)+(1.029)+(2.028), (I-746)+(1.029)+(2.029), (I-746)+(1.029)+(2.030), (I-746)+(1.029)+(2.031), (I-746)+(1.029)+(2.032), (I-746)+(1.029)+(2.033), (I-746)+(1.029)+(2.034), (I-746)+(1.029)+(2.035), (I-746)+(1.029)+(2.036), (I-746)+(1.029)+(2.037), (I-746)+(1.029)+(2.038), (I-746)+(1.029)+(2.039), (I-746)+(1.029)+(2.040), (I-746)+(1.029)+(2.041), (I-746)+(1.029)+(2.042), (I-746)+(1.029)+(2.043), (I-746)+(1.029)+(2.044), (I-746)+(1.029)+(2.045), (I-746)+(1.029)+(2.046), (I-746)+(1.029)+(2.047), (I-746)+(1.029)+(2.048), (I-746)+(1.029)+(2.049), (I-746)+(1.029)+(2.050), (I-746)+(1.029)+(2.051), (I-746)+(1.029)+(2.052), (I-746)+(1.029)+(2.053), (I-746)+(1.029)+(2.054), (I-746)+(1.029)+(2.055), (I-746)+(1.029)+(2.056), (I-746)+(1.029)+(2.057), (I-746)+(1.029)+(2.058), (I-746)+(1.029)+(2.059), (I-746)+(1.029)+(3.001), (I-746)+(1.029)+(3.002), (I-746)+(1.029)+(3.003), (I-746)+(1.029)+(3.004), (I-746)+(1.029)+(3.005), (I-746)+(1.029)+(3.006), (I-746)+(1.029)+(3.007), (I-746)+(1.029)+(3.008), (I-746)+(1.029)+(3.009), (I-746)+(1.029)+(3.010), (I-746)+(1.029)+(3.011), (I-746)+(1.029)+(3.012), (I-746)+(1.029)+(3.013), (I-746)+(1.029)+(3.014), (I-746)+(1.029)+(3.015), (I-746)+(1.029)+(3.016), (I-746)+(1.029)+(3.017), (I-746)+(1.029)+(3.018), (I-746)+(1.029)+(3.019), (I-746)+(1.029)+(3.020), (I-746)+(1.029)+(3.021), (I-746)+(1.029)+(3.022), (I-746)+(1.029)+(3.023), (I-746)+(1.029)+(3.024), (I-746)+(1.029)+(3.025), (I-746)+(1.029)+(3.026), (I-746)+(1.029)+(3.027), (I-746)+(1.029)+(3.028), (I-746)+(1.029)+(3.029), (I-746)+(1.029)+(3.030), (I-746)+(1.029)+(3.031), (I-746)+(1.029)+(5.001), (I-746)+(1.029)+(5.002), (I-746)+(1.029)+(5.003), (I-746)+(1.029)+(5.004), (I-746)+(1.029)+(5.005), (I-746)+(1.029)+(5.006), (I-746)+(1.029)+(5.007), (I-746)+(1.029)+(5.008), (I-746)+(1.029)+(5.009), (I-746)+(1.029)+(5.010), (I-746)+(1.029)+(5.011), (I-746)+(1.029)+(5.012), (I-746)+(1.029)+(5.013), (I-746)+(1.029)+(5.014), (I-746)+(1.029)+(5.015), (I-746)+(1.029)+(5.016), (I-746)+(1.029)+(5.017), (I-746)+(1.029)+(5.018), (I-746)+(1.029)+(5.019), (I-746)+(1.029)+(5.020), (I-746)+(1.029)+(5.021), (I-746)+(1.029)+(5.022), (I-746)+(1.029)+(5.023), (I-746)+(1.029)+(6.001), (I-746)+(1.029)+(6.002), (I-746)+(1.029)+(6.003), (I-746)+(1.029)+(6.004), (I-746)+(1.029)+(7.001), (I-746)+(1.029)+(7.002), (I-746)+(1.029)+(7.003), (I-746)+(1.029)+(7.004), (I-746)+(1.029)+(7.005), (I-746)+(1.029)+(7.006), (I-746)+(1.029)+(9.001), (I-746)+(1.029)+(9.002), (I-746)+(1.029)+(9.003), (I-746)+(1.029)+(9.004), (I-746)+(1.029)+(9.005), (I-746)+(1.029)+(9.006), (I-746)+(1.029)+(9.007), (I-746)+(1.029)+(9.008), (I-746)+(1.029)+(9.009), (I-746)+(1.029)+(14.001), (I-746)+(1.029)+(14.002), (I-746)+(1.029)+(15.008), (I-746)+(1.029)+(15.011), (I-746)+(1.029)+(15.012), (I-746)+(1.029)+(15.016), (I-746)+(1.029)+(15.025), (I-746)+(1.029)+(15.027), (I-746)+(1.029)+(15.047), (I-746)+(1.029)+(15.063), (I-746)+(1.029)+(15.064), (I-746)+(1.029)+(16.001), (I-746)+(1.029)+(16.002), (I-746)+(1.029)+(16.003), (I-746)+(1.029)+(16.004), (I-746)+(1.029)+(16.005), (I-746)+(1.029)+(16.006), (I-746)+(1.029)+(16.007), (I-746)+(1.029)+(16.008), (I-746)+(1.029)+(17.001), (I-746)+(1.029)+(17.002), (I-746)+(1.029)+(17.003), (I-746)+(1.029)+(17.004), (I-746)+(1.029)+(17.005), (I-746)+(1.029)+(17.006), (I-746)+(1.029)+(17.007), (I-746)+(1.029)+(17.008), (I-746)+(1.029)+(17.009), (I-746)+(1.029)+(17.010), (I-746)+(1.029)+(17.011), (I-746)+(1.029)+(17.012), (I-746)+(1.029)+(18.001),

(I-746)+(1.030)+(1.031), (I-746)+(1.030)+(1.032), (I-746)+(1.030)+(1.033), (I-746)+(1.030)+(1.034), (I-746)+(1.030)+(1.035), (I-746)+(1.030)+(1.036), (I-746)+(1.030)+(1.037), (I-746)+(1.030)+(1.038), (I-746)+(1.030)+(1.039), (I-746)+(1.030)+(1.040), (I-746)+(1.030)+(1.041), (I-746)+(1.030)+(1.042), (I-746)+(1.030)+(1.043), (I-746)+(1.030)+(1.044), (I-746)+(1.030)+(1.045), (I-746)+(1.030)+(1.046), (I-746)+(1.030)+(1.047), (I-746)+(1.030)+(1.048), (I-746)+(1.030)+(1.049), (I-746)+(1.030)+(1.050), (I-746)+(1.030)+(1.051), (I-746)+(1.030)+(1.052), (I-746)+(1.030)+(1.053), (I-746)+(1.030)+(1.054), (I-746)+(1.030)+(1.055), (I-746)+(1.030)+(1.056), (I-746)+(1.030)+(1.057), (I-746)+(1.030)+(1.058), (I-746)+(1.030)+(1.059), (I-746)+(1.030)+(1.060), (I-746)+(1.030)+(1.061), (I-746)+(1.030)+(1.062), (I-746)+(1.030)+(1.063), (I-746)+(1.030)+(1.064), (I-746)+(1.030)+(1.065), (I-746)+(1.030)+(1.066), (I-746)+(1.030)+(1.067), (I-746)+(1.030)+(1.068), (I-746)+(1.030)+(1.069), (I-746)+(1.030)+(1.070), (I-746)+(1.030)+(1.071), (I-746)+(1.030)+(1.072), (I-746)+(1.030)+(1.073), (I-746)+(1.030)+(1.074), (I-746)+(1.030)+(1.075), (I-746)+(1.030)+(1.076), (I-746)+(1.030)+(1.077), (I-746)+(1.030)+(1.078), (I-746)+(1.030)+(1.079), (I-746)+(1.030)+(1.080), (I-746)+(1.030)+(1.081), (I-746)+(1.030)+(1.082), (I-746)+(1.030)+(1.083), (I-746)+(1.030)+(1.084), (I-746)+(1.030)+(1.085), (I-746)+(1.030)+(1.086), (I-746)+(1.030)+(1.087), (I-746)+(1.030)+(1.088), (I-746)+(1.030)+(1.089), (I-746)+(1.030)+(1.090), (I-746)+(1.030)+(1.091), (I-746)+(1.030)+(1.092), (I-746)+(1.030)+(2.001), (I-746)+(1.030)+(2.002), (I-746)+(1.030)+(2.003), (I-746)+(1.030)+(2.004), (I-746)+(1.030)+(2.005), (I-746)+(1.030)+(2.006), (I-746)+(1.030)+(2.007), (I-746)+(1.030)+(2.008), (I-746)+(1.030)+(2.009), (I-746)+(1.030)+(2.010), (I-746)+(1.030)+(2.011), (I-746)+(1.030)+(2.012), (I-746)+(1.030)+(2.013), (I-746)+(1.030)+(2.014), (I-746)+(1.030)+(2.015), (I-746)+(1.030)+(2.016), (I-746)+(1.030)+(2.017), (I-746)+(1.030)+(2.018), (I-746)+(1.030)+(2.019), (I-746)+(1.030)+(2.020), (I-746)+(1.030)+(2.021), (I-746)+(1.030)+(2.022), (I-746)+(1.030)+(2.023), (I-746)+(1.030)+(2.024), (I-746)+(1.030)+(2.025), (I-746)+(1.030)+(2.026), (I-746)+(1.030)+(2.027), (I-746)+(1.030)+(2.028), (I-746)+(1.030)+(2.029), (I-746)+(1.030)+(2.030), (I-746)+(1.030)+(2.031), (I-746)+(1.030)+(2.032), (I-746)+(1.030)+(2.033), (I-746)+(1.030)+(2.034), (I-746)+(1.030)+(2.035), (I-746)+(1.030)+(2.036), (I-746)+(1.030)+(2.037), (I-746)+(1.030)+(2.038), (I-746)+(1.030)+(2.039), (I-746)+(1.030)+(2.040), (I-746)+(1.030)+(2.041), (I-746)+(1.030)+(2.042), (I-746)+(1.030)+(2.043), (I-746)+(1.030)+(2.044), (I-746)+(1.030)+(2.045), (I-746)+(1.030)+(2.046), (I-746)+(1.030)+(2.047), (I-746)+(1.030)+(2.048), (I-746)+(1.030)+(2.049), (I-746)+(1.030)+(2.050), (I-746)+(1.030)+(2.051), (I-746)+(1.030)+(2.052), (I-746)+(1.030)+(2.053), (I-746)+(1.030)+(2.054), (I-746)+(1.030)+(2.055), (I-746)+(1.030)+(2.056), (I-746)+(1.030)+(2.057), (I-746)+(1.030)+(2.058), (I-746)+(1.030)+(2.059), (I-746)+(1.030)+(3.001), (I-746)+(1.030)+(3.002), (I-746)+(1.030)+(3.003), (I-746)+(1.030)+(3.004), (I-746)+(1.030)+(3.005), (I-746)+(1.030)+(3.006), (I-746)+(1.030)+(3.007), (I-746)+(1.030)+(3.008), (I-746)+(1.030)+(3.009), (I-746)+(1.030)+(3.010), (I-746)+(1.030)+(3.011), (I-746)+(1.030)+(3.012), (I-746)+(1.030)+(3.013), (I-746)+(1.030)+(3.014), (I-746)+(1.030)+(3.015), (I-746)+(1.030)+(3.016), (I-746)+(1.030)+(3.017), (I-746)+(1.030)+(3.018), (I-746)+(1.030)+(3.019), (I-746)+(1.030)+(3.020), (I-746)+(1.030)+(3.021), (I-746)+(1.030)+(3.022), (I-746)+(1.030)+(3.023), (I-746)+(1.030)+(3.024), (I-746)+(1.030)+(3.025), (I-746)+(1.030)+(3.026), (I-746)+(1.030)+(3.027), (I-746)+(1.030)+(3.028), (I-746)+(1.030)+(3.029), (I-746)+(1.030)+(3.030), (I-746)+(1.030)+(3.031), (I-746)+(1.030)+(5.001), (I-746)+(1.030)+(5.002), (I-746)+(1.030)+(5.003), (I-746)+(1.030)+(5.004), (I-746)+(1.030)+(5.005), (I-746)+(1.030)+(5.006), (I-746)+(1.030)+(5.007), (I-746)+(1.030)+(5.008), (I-746)+(1.030)+(5.009), (I-746)+(1.030)+(5.010), (I-746)+(1.030)+(5.011), (I-746)+(1.030)+(5.012), (I-746)+(1.030)+(5.013), (I-746)+(1.030)+(5.014), (I-746)+(1.030)+(5.015), (I-746)+(1.030)+(5.016), (I-746)+(1.030)+(5.017), (I-746)+(1.030)+(5.018), (I-746)+(1.030)+(5.019), (I-746)+(1.030)+(5.020), (I-746)+(1.030)+(5.021), (I-746)+(1.030)+(5.022), (I-746)+(1.030)+(5.023), (I-746)+(1.030)+(6.001), (I-746)+(1.030)+(6.002), (I-746)+(1.030)+(6.003), (I-746)+(1.030)+(6.004), (I-746)+(1.030)+(7.001), (I-746)+(1.030)+(7.002), (I-746)+(1.030)+(7.003), (I-746)+(1.030)+(7.004), (I-746)+(1.030)+(7.005), (I-746)+(1.030)+(7.006), (I-746)+(1.030)+(9.001), (I-746)+(1.030)+(9.002), (I-746)+(1.030)+(9.003), (I-746)+(1.030)+(9.004), (I-746)+(1.030)+(9.005), (I-746)+(1.030)+(9.006), (I-746)+(1.030)+(9.007), (I-746)+(1.030)+(9.008), (I-746)+(1.030)+(9.009), (I-746)+(1.030)+(14.001), (I-746)+(1.030)+(14.002), (I-746)+(1.030)+(15.008), (I-746)+(1.030)+(15.011), (I-746)+(1.030)+(15.012), (I-746)+(1.030)+(15.016), (I-746)+(1.030)+(15.025), (I-746)+(1.030)+(15.027), (I-746)+(1.030)+(15.047), (I-746)+(1.030)+(15.063), (I-746)+(1.030)+(15.064), (I-746)+(1.030)+(16.001), (I-746)+(1.030)+(16.002), (I-746)+(1.030)+(16.003), (I-746)+(1.030)+(16.004), (I-746)+(1.030)+(16.005), (I-746)+(1.030)+(16.006), (I-746)+(1.030)+(16.007), (I-746)+(1.030)+(16.008), (I-746)+(1.030)+(17.001), (I-746)+(1.030)+(17.002), (I-746)+(1.030)+(17.003), (I-746)+(1.030)+(17.004), (I-746)+(1.030)+(17.005), (I-746)+(1.030)+(17.006), (I-746)+(1.030)+(17.007), (I-746)+(1.030)+(17.008), (I-746)+(1.030)+(17.009), (I-746)+(1.030)+(17.010), (I-746)+(1.030)+(17.011), (I-746)+(1.030)+(17.012), (I-746)+(1.030)+(18.001),

(I-746)+(1.031)+(1.032), (I-746)+(1.031)+(1.033), (I-746)+(1.031)+(1.034), (I-746)+(1.031)+(1.035), (I-746)+(1.031)+(1.036), (I-746)+(1.031)+(1.037), (I-746)+(1.031)+(1.038), (I-746)+(1.031)+(1.039), (I-746)+(1.031)+(1.040), (I-746)+(1.031)+(1.041), (I-746)+(1.031)+(1.042), (I-746)+(1.031)+(1.043), (I-746)+(1.031)+(1.044), (I-746)+(1.031)+(1.045), (I-746)+(1.031)+(1.046), (I-746)+(1.031)+(1.047), (I-746)+(1.031)+(1.048), (I-746)+(1.031)+(1.049), (I-746)+(1.031)+(1.050), (I-746)+(1.031)+(1.051), (I-746)+(1.031)+(1.052), (I-746)+(1.031)+(1.053), (I-746)+(1.031)+(1.054), (I-746)+(1.031)+(1.055), (I-746)+(1.031)+(1.056), (I-746)+(1.031)+(1.057), (I-746)+(1.031)+(1.058), (I-746)+(1.031)+(1.059), (I-746)+(1.031)+(1.060), (I-746)+(1.031)+(1.061), (I-746)+(1.031)+(1.062), (I-746)+(1.031)+(1.063), (I-746)+(1.031)+(1.064), (I-746)+(1.031)+(1.065), (I-746)+(1.031)+(1.066), (I-746)+(1.031)+(1.067), (I-746)+(1.031)+(1.068), (I-746)+(1.031)+(1.069), (I-746)+(1.031)+(1.070), (I-746)+(1.031)+(1.071), (I-746)+(1.031)+(1.072), (I-746)+(1.031)+(1.073), (I-746)+(1.031)+(1.074), (I-746)+(1.031)+(1.075), (I-746)+(1.031)+(1.076), (I-746)+(1.031)+(1.077), (I-746)+(1.031)+(1.078), (I-746)+(1.031)+(1.079), (I-746)+(1.031)+(1.080), (I-746)+(1.031)+(1.081), (I-746)+(1.031)+(1.082), (I-746)+(1.031)+(1.083), (I-746)+(1.031)+(1.084), (I-746)+(1.031)+(1.085), (I-746)+(1.031)+(1.086), (I-746)+(1.031)+(1.087), (I-746)+(1.031)+(1.088), (I-746)+(1.031)+(1.089), (I-746)+(1.031)+(1.090), (I-746)+(1.031)+(1.091), (I-746)+(1.031)+(1.092), (I-746)+(1.031)+(2.001), (I-746)+(1.031)+(2.002), (I-746)+(1.031)+(2.003), (I-746)+(1.031)+(2.004), (I-746)+(1.031)+(2.005), (I-746)+(1.031)+(2.006), (I-746)+(1.031)+(2.007), (I-746)+(1.031)+(2.008), (I-746)+(1.031)+(2.009), (I-746)+(1.031)+(2.010), (I-746)+(1.031)+(2.011), (I-746)+(1.031)+(2.012), (I-746)+(1.031)+(2.013), (I-746)+(1.031)+(2.014), (I-746)+(1.031)+(2.015), (I-746)+(1.031)+(2.016), (I-746)+(1.031)+(2.017), (I-746)+(1.031)+(2.018), (I-746)+(1.031)+(2.019), (I-746)+(1.031)+(2.020), (I-746)+(1.031)+(2.021), (I-746)+(1.031)+(2.022), (I-746)+(1.031)+(2.023), (I-746)+(1.031)+(2.024), (I-746)+(1.031)+(2.025), (I-746)+(1.031)+(2.026), (I-746)+(1.031)+(2.027), (I-746)+(1.031)+(2.028), (I-746)+(1.031)+(2.029), (I-746)+(1.031)+(2.030), (I-746)+(1.031)+(2.031), (I-746)+(1.031)+(2.032), (I-746)+(1.031)+(2.033), (I-746)+(1.031)+(2.034), (I-746)+(1.031)+(2.035), (I-746)+(1.031)+(2.036), (I-746)+(1.031)+(2.037), (I-746)+(1.031)+(2.038), (I-746)+(1.031)+(2.039), (I-746)+(1.031)+(2.040), (I-746)+(1.031)+(2.041), (I-746)+(1.031)+(2.042), (I-746)+(1.031)+(2.043), (I-746)+(1.031)+(2.044), (I-746)+(1.031)+(2.045), (I-746)+(1.031)+(2.046), (I-746)+(1.031)+(2.047), (I-746)+(1.031)+(2.048), (I-746)+(1.031)+(2.049), (I-746)+(1.031)+(2.050), (I-746)+(1.031)+(2.051), (I-746)+(1.031)+(2.052), (I-746)+(1.031)+(2.053), (I-746)+(1.031)+(2.054), (I-746)+(1.031)+(2.055), (I-746)+(1.031)+(2.056), (I-746)+(1.031)+(2.057), (I-746)+(1.031)+(2.058), (I-746)+(1.031)+(2.059), (I-746)+(1.031)+(3.001), (I-746)+(1.031)+(3.002), (I-746)+(1.031)+(3.003), (I-746)+(1.031)+(3.004), (I-746)+(1.031)+(3.005), (I-746)+(1.031)+(3.006), (I-746)+(1.031)+(3.007), (I-746)+(1.031)+(3.008), (I-746)+(1.031)+(3.009), (I-746)+(1.031)+(3.010), (I-746)+(1.031)+(3.011), (I-746)+(1.031)+(3.012), (I-746)+(1.031)+(3.013), (I-746)+(1.031)+(3.014), (I-746)+(1.031)+(3.015), (I-746)+(1.031)+(3.016), (I-746)+(1.031)+(3.017), (I-746)+(1.031)+(3.018), (I-746)+(1.031)+(3.019), (I-746)+(1.031)+(3.020), (I-746)+(1.031)+(3.021), (I-746)+(1.031)+(3.022), (I-746)+(1.031)+(3.023), (I-746)+(1.031)+(3.024), (I-746)+(1.031)+(3.025), (I-746)+(1.031)+(3.026), (I-746)+(1.031)+(3.027), (I-746)+(1.031)+(3.028), (I-746)+(1.031)+(3.029), (I-746)+(1.031)+(3.030), (I-746)+(1.031)+(3.031), (I-746)+(1.031)+(5.001), (I-746)+(1.031)+(5.002), (I-746)+(1.031)+(5.003), (I-746)+(1.031)+(5.004), (I-746)+(1.031)+(5.005), (I-746)+(1.031)+(5.006), (I-746)+(1.031)+(5.007), (I-746)+(1.031)+(5.008), (I-746)+(1.031)+(5.009), (I-746)+(1.031)+(5.010), (I-746)+(1.031)+(5.011), (I-746)+(1.031)+(5.012), (I-746)+(1.031)+(5.013), (I-746)+(1.031)+(5.014), (I-746)+(1.031)+(5.015), (I-746)+(1.031)+(5.016), (I-746)+(1.031)+(5.017), (I-746)+(1.031)+(5.018), (I-746)+(1.031)+(5.019), (I-746)+(1.031)+(5.020), (I-746)+(1.031)+(5.021), (I-746)+(1.031)+(5.022), (I-746)+(1.031)+(5.023), (I-746)+(1.031)+(6.001), (I-746)+(1.031)+(6.002), (I-746)+(1.031)+(6.003), (I-746)+(1.031)+(6.004), (I-746)+(1.031)+(7.001), (I-746)+(1.031)+(7.002), (I-746)+(1.031)+(7.003), (I-746)+(1.031)+(7.004), (I-746)+(1.031)+(7.005), (I-746)+(1.031)+(7.006), (I-746)+(1.031)+(9.001), (I-746)+(1.031)+(9.002), (I-746)+(1.031)+(9.003), (I-746)+(1.031)+(9.004), (I-746)+(1.031)+(9.005), (I-746)+(1.031)+(9.006), (I-746)+(1.031)+(9.007), (I-746)+(1.031)+(9.008), (I-746)+(1.031)+(9.009), (I-746)+(1.031)+(14.001), (I-746)+(1.031)+(14.002), (I-746)+(1.031)+(15.008), (I-746)+(1.031)+(15.011), (I-746)+(1.031)+(15.012), (I-746)+(1.031)+(15.016), (I-746)+(1.031)+(15.025), (I-746)+(1.031)+(15.027), (I-746)+(1.031)+(15.047), (I-746)+(1.031)+(15.063), (I-746)+(1.031)+(15.064), (I-746)+(1.031)+(16.001), (I-746)+(1.031)+(16.002), (I-746)+(1.031)+(16.003), (I-746)+(1.031)+(16.004), (I-746)+(1.031)+(16.005), (I-746)+(1.031)+(16.006), (I-746)+(1.031)+(16.007), (I-746)+(1.031)+(16.008), (I-746)+(1.031)+(17.001), (I-746)+(1.031)+(17.002), (I-746)+(1.031)+(17.003), (I-746)+(1.031)+(17.004), (I-746)+(1.031)+(17.005), (I-746)+(1.031)+(17.006), (I-746)+(1.031)+(17.007), (I-746)+(1.031)+(17.008), (I-746)+(1.031)+(17.009), (I-746)+(1.031)+(17.010), (I-746)+(1.031)+(17.011), (I-746)+(1.031)+(17.012), (I-746)+(1.031)+(18.001),

(I-746)+(1.032)+(1.033), (I-746)+(1.032)+(1.034), (I-746)+(1.032)+(1.035), (I-746)+(1.032)+(1.036), (I-746)+(1.032)+(1.037), (I-746)+(1.032)+(1.038), (I-746)+(1.032)+(1.039), (I-746)+(1.032)+(1.040), (I-746)+(1.032)+(1.041), (I-746)+(1.032)+(1.042), (I-746)+(1.032)+(1.043), (I-746)+(1.032)+(1.044), (I-746)+(1.032)+(1.045), (I-746)+(1.032)+(1.046), (I-746)+(1.032)+(1.047), (I-746)+(1.032)+(1.048), (I-746)+(1.032)+(1.049), (I-746)+(1.032)+(1.050), (I-746)+(1.032)+(1.051), (I-746)+(1.032)+(1.052), (I-746)+(1.032)+(1.053), (I-746)+(1.032)+(1.054), (I-746)+(1.032)+(1.055), (I-746)+(1.032)+(1.056), (I-746)+(1.032)+(1.057), (I-746)+(1.032)+(1.058), (I-746)+(1.032)+(1.059), (I-746)+(1.032)+(1.060), (I-746)+(1.032)+(1.061), (I-746)+(1.032)+(1.062), (I-746)+(1.032)+(1.063), (I-746)+(1.032)+(1.064), (I-746)+(1.032)+(1.065), (I-746)+(1.032)+(1.066), (I-746)+(1.032)+(1.067), (I-746)+(1.032)+(1.068), (I-746)+(1.032)+(1.069), (I-746)+(1.032)+(1.070), (I-746)+(1.032)+(1.071), (I-746)+(1.032)+(1.072), (I-746)+(1.032)+(1.073), (I-746)+(1.032)+(1.074), (I-746)+(1.032)+(1.075), (I-746)+(1.032)+(1.076), (I-746)+(1.032)+(1.077), (I-746)+(1.032)+(1.078), (I-746)+(1.032)+(1.079), (I-746)+(1.032)+(1.080), (I-746)+(1.032)+(1.081), (I-746)+(1.032)+(1.082), (I-746)+(1.032)+(1.083), (I-746)+(1.032)+(1.084), (I-746)+(1.032)+(1.085), (I-746)+(1.032)+(1.086), (I-746)+(1.032)+(1.087), (I-746)+(1.032)+(1.088), (I-746)+(1.032)+(1.089), (I-746)+(1.032)+(1.090), (I-746)+(1.032)+(1.091), (I-746)+(1.032)+(1.092), (I-746)+(1.032)+(2.001), (I-746)+(1.032)+(2.002), (I-746)+(1.032)+(2.003), (I-746)+(1.032)+(2.004), (I-746)+(1.032)+(2.005), (I-746)+(1.032)+(2.006), (I-746)+(1.032)+(2.007), (I-746)+(1.032)+(2.008), (I-746)+(1.032)+(2.009), (I-746)+(1.032)+(2.010), (I-746)+(1.032)+(2.011), (I-746)+(1.032)+(2.012), (I-746)+(1.032)+(2.013), (I-746)+(1.032)+(2.014), (I-746)+(1.032)+(2.015), (I-746)+(1.032)+(2.016), (I-746)+(1.032)+(2.017), (I-746)+(1.032)+(2.018), (I-746)+(1.032)+(2.019), (I-746)+(1.032)+(2.020), (I-746)+(1.032)+(2.021), (I-746)+(1.032)+(2.022), (I-746)+(1.032)+(2.023), (I-746)+(1.032)+(2.024), (I-746)+(1.032)+(2.025), (I-746)+(1.032)+(2.026), (I-746)+(1.032)+(2.027), (I-746)+(1.032)+(2.028), (I-746)+(1.032)+(2.029), (I-746)+(1.032)+(2.030), (I-746)+(1.032)+(2.031), (I-746)+(1.032)+(2.032), (I-746)+(1.032)+(2.033), (I-746)+(1.032)+(2.034), (I-746)+(1.032)+(2.035), (I-746)+(1.032)+(2.036), (I-746)+(1.032)+(2.037), (I-746)+(1.032)+(2.038), (I-746)+(1.032)+(2.039), (I-746)+(1.032)+(2.040), (I-746)+(1.032)+(2.041), (I-746)+(1.032)+(2.042), (I-746)+(1.032)+(2.043), (I-746)+(1.032)+(2.044), (I-746)+(1.032)+(2.045), (I-746)+(1.032)+(2.046), (I-746)+(1.032)+(2.047), (I-746)+(1.032)+(2.048), (I-746)+(1.032)+(2.049), (I-746)+(1.032)+(2.050), (I-746)+(1.032)+(2.051), (I-746)+(1.032)+(2.052), (I-746)+(1.032)+(2.053), (I-746)+(1.032)+(2.054), (I-746)+(1.032)+(2.055), (I-746)+(1.032)+(2.056), (I-746)+(1.032)+(2.057), (I-746)+(1.032)+(2.058), (I-746)+(1.032)+(2.059), (I-746)+(1.032)+(3.001), (I-746)+(1.032)+(3.002), (I-746)+(1.032)+(3.003), (I-746)+(1.032)+(3.004), (I-746)+(1.032)+(3.005), (I-746)+(1.032)+(3.006), (I-746)+(1.032)+(3.007), (I-746)+(1.032)+(3.008), (I-746)+(1.032)+(3.009), (I-746)+(1.032)+(3.010), (I-746)+(1.032)+(3.011), (I-746)+(1.032)+(3.012), (I-746)+(1.032)+(3.013), (I-746)+(1.032)+(3.014), (I-746)+(1.032)+(3.015), (I-746)+(1.032)+(3.016), (I-746)+(1.032)+(3.017), (I-746)+(1.032)+(3.018), (I-746)+(1.032)+(3.019), (I-746)+(1.032)+(3.020), (I-746)+(1.032)+(3.021), (I-746)+(1.032)+(3.022), (I-746)+(1.032)+(3.023), (I-746)+(1.032)+(3.024), (I-746)+(1.032)+(3.025), (I-746)+(1.032)+(3.026), (I-746)+(1.032)+(3.027), (I-746)+(1.032)+(3.028), (I-746)+(1.032)+(3.029), (I-746)+(1.032)+(3.030), (I-746)+(1.032)+(3.031), (I-746)+(1.032)+(5.001), (I-746)+(1.032)+(5.002), (I-746)+(1.032)+(5.003), (I-746)+(1.032)+(5.004), (I-746)+(1.032)+(5.005), (I-746)+(1.032)+(5.006), (I-746)+(1.032)+(5.007), (I-746)+(1.032)+(5.008), (I-746)+(1.032)+(5.009), (I-746)+(1.032)+(5.010), (I-746)+(1.032)+(5.011), (I-746)+(1.032)+(5.012), (I-746)+(1.032)+(5.013), (I-746)+(1.032)+(5.014), (I-746)+(1.032)+(5.015), (I-746)+(1.032)+(5.016), (I-746)+(1.032)+(5.017), (I-746)+(1.032)+(5.018), (I-746)+(1.032)+(5.019), (I-746)+(1.032)+(5.020), (I-746)+(1.032)+(5.021), (I-746)+(1.032)+(5.022), (I-746)+(1.032)+(5.023), (I-746)+(1.032)+(6.001), (I-746)+(1.032)+(6.002), (I-746)+(1.032)+(6.003), (I-746)+(1.032)+(6.004), (I-746)+(1.032)+(7.001), (I-746)+(1.032)+(7.002), (I-746)+(1.032)+(7.003), (I-746)+(1.032)+(7.004), (I-746)+(1.032)+(7.005), (I-746)+(1.032)+(7.006), (I-746)+(1.032)+(9.001), (I-746)+(1.032)+(9.002), (I-746)+(1.032)+(9.003), (I-746)+(1.032)+(9.004), (I-746)+(1.032)+(9.005), (I-746)+(1.032)+(9.006), (I-746)+(1.032)+(9.007), (I-746)+(1.032)+(9.008), (I-746)+(1.032)+(9.009), (I-746)+(1.032)+(14.001), (I-746)+(1.032)+(14.002), (I-746)+(1.032)+(15.008), (I-746)+(1.032)+(15.011), (I-746)+(1.032)+(15.012), (I-746)+(1.032)+(15.016), (I-746)+(1.032)+(15.025), (I-746)+(1.032)+(15.027), (I-746)+(1.032)+(15.047), (I-746)+(1.032)+(15.063), (I-746)+(1.032)+(15.064), (I-746)+(1.032)+(16.001), (I-746)+(1.032)+(16.002), (I-746)+(1.032)+(16.003), (I-746)+(1.032)+(16.004), (I-746)+(1.032)+(16.005), (I-746)+(1.032)+(16.006), (I-746)+(1.032)+(16.007), (I-746)+(1.032)+(16.008), (I-746)+(1.032)+(17.001), (I-746)+(1.032)+(17.002), (I-746)+(1.032)+(17.003), (I-746)+(1.032)+(17.004), (I-746)+(1.032)+(17.005), (I-746)+(1.032)+(17.006), (I-746)+(1.032)+(17.007), (I-746)+(1.032)+(17.008), (I-746)+(1.032)+(17.009), (I-746)+(1.032)+(17.010), (I-746)+(1.032)+(17.011), (I-746)+(1.032)+(17.012), (I-746)+(1.032)+(18.001),

(I-746)+(1.033)+(1.034), (I-746)+(1.033)+(1.035), (I-746)+(1.033)+(1.036), (I-746)+(1.033)+(1.037), (I-746)+(1.033)+(1.038), (I-746)+(1.033)+(1.039), (I-746)+(1.033)+(1.040), (I-746)+(1.033)+(1.041), (I-746)+(1.033)+(1.042), (I-746)+(1.033)+(1.043), (I-746)+(1.033)+(1.044), (I-746)+(1.033)+(1.045), (I-746)+(1.033)+(1.046), (I-746)+(1.033)+(1.047), (I-746)+(1.033)+(1.048), (I-746)+(1.033)+(1.049), (I-746)+(1.033)+(1.050), (I-746)+(1.033)+(1.051), (I-746)+(1.033)+(1.052), (I-746)+(1.033)+(1.053), (I-746)+(1.033)+(1.054), (I-746)+(1.033)+(1.055), (I-746)+(1.033)+(1.056), (I-746)+(1.033)+(1.057), (I-746)+(1.033)+(1.058), (I-746)+(1.033)+(1.059), (I-746)+(1.033)+(1.060), (I-746)+(1.033)+(1.061), (I-746)+(1.033)+(1.062), (I-746)+(1.033)+(1.063), (I-746)+(1.033)+(1.064), (I-746)+(1.033)+(1.065), (I-746)+(1.033)+(1.066), (I-746)+(1.033)+(1.067), (I-746)+(1.033)+(1.068), (I-746)+(1.033)+(1.069), (I-746)+(1.033)+(1.070), (I-746)+(1.033)+(1.071), (I-746)+(1.033)+(1.072), (I-746)+(1.033)+(1.073), (I-746)+(1.033)+(1.074), (I-746)+(1.033)+(1.075), (I-746)+(1.033)+(1.076), (I-746)+(1.033)+(1.077), (I-746)+(1.033)+(1.078), (I-746)+(1.033)+(1.079), (I-746)+(1.033)+(1.080), (I-746)+(1.033)+(1.081), (I-746)+(1.033)+(1.082), (I-746)+(1.033)+(1.083), (I-746)+(1.033)+(1.084), (I-746)+(1.033)+(1.085), (I-746)+(1.033)+(1.086), (I-746)+(1.033)+(1.087), (I-746)+(1.033)+(1.088), (I-746)+(1.033)+(1.089), (I-746)+(1.033)+(1.090), (I-746)+(1.033)+(1.091), (I-746)+(1.033)+(1.092), (I-746)+(1.033)+(2.001), (I-746)+(1.033)+(2.002), (I-746)+(1.033)+(2.003), (I-746)+(1.033)+(2.004), (I-746)+(1.033)+(2.005), (I-746)+(1.033)+(2.006), (I-746)+(1.033)+(2.007), (I-746)+(1.033)+(2.008), (I-746)+(1.033)+(2.009), (I-746)+(1.033)+(2.010), (I-746)+(1.033)+(2.011), (I-746)+(1.033)+(2.012), (I-746)+(1.033)+(2.013), (I-746)+(1.033)+(2.014), (I-746)+(1.033)+(2.015), (I-746)+(1.033)+(2.016), (I-746)+(1.033)+(2.017), (I-746)+(1.033)+(2.018), (I-746)+(1.033)+(2.019), (I-746)+(1.033)+(2.020), (I-746)+(1.033)+(2.021), (I-746)+(1.033)+(2.022), (I-746)+(1.033)+(2.023), (I-746)+(1.033)+(2.024), (I-746)+(1.033)+(2.025), (I-746)+(1.033)+(2.026), (I-746)+(1.033)+(2.027), (I-746)+(1.033)+(2.028), (I-746)+(1.033)+(2.029), (I-746)+(1.033)+(2.030), (I-746)+(1.033)+(2.031), (I-746)+(1.033)+(2.032), (I-746)+(1.033)+(2.033), (I-746)+(1.033)+(2.034), (I-746)+(1.033)+(2.035), (I-746)+(1.033)+(2.036), (I-746)+(1.033)+(2.037), (I-746)+(1.033)+(2.038), (I-746)+(1.033)+(2.039), (I-746)+(1.033)+(2.040), (I-746)+(1.033)+(2.041), (I-746)+(1.033)+(2.042), (I-746)+(1.033)+(2.043), (I-746)+(1.033)+(2.044), (I-746)+(1.033)+(2.045), (I-746)+(1.033)+(2.046), (I-746)+(1.033)+(2.047), (I-746)+(1.033)+(2.048), (I-746)+(1.033)+(2.049), (I-746)+(1.033)+(2.050), (I-746)+(1.033)+(2.051), (I-746)+(1.033)+(2.052), (I-746)+(1.033)+(2.053), (I-746)+(1.033)+(2.054), (I-746)+(1.033)+(2.055), (I-746)+(1.033)+(2.056), (I-746)+(1.033)+(2.057), (I-746)+(1.033)+(2.058), (I-746)+(1.033)+(2.059), (I-746)+(1.033)+(3.001), (I-746)+(1.033)+(3.002), (I-746)+(1.033)+(3.003), (I-746)+(1.033)+(3.004), (I-746)+(1.033)+(3.005), (I-746)+(1.033)+(3.006), (I-746)+(1.033)+(3.007), (I-746)+(1.033)+(3.008), (I-746)+(1.033)+(3.009), (I-746)+(1.033)+(3.010), (I-746)+(1.033)+(3.011), (I-746)+(1.033)+(3.012), (I-746)+(1.033)+(3.013), (I-746)+(1.033)+(3.014), (I-746)+(1.033)+(3.015), (I-746)+(1.033)+(3.016), (I-746)+(1.033)+(3.017), (I-746)+(1.033)+(3.018), (I-746)+(1.033)+(3.019), (I-746)+(1.033)+(3.020), (I-746)+(1.033)+(3.021), (I-746)+(1.033)+(3.022), (I-746)+(1.033)+(3.023), (I-746)+(1.033)+(3.024), (I-746)+(1.033)+(3.025), (I-746)+(1.033)+(3.026), (I-746)+(1.033)+(3.027), (I-746)+(1.033)+(3.028), (I-746)+(1.033)+(3.029), (I-746)+(1.033)+(3.030), (I-746)+(1.033)+(3.031), (I-746)+(1.033)+(5.001), (I-746)+(1.033)+(5.002), (I-746)+(1.033)+(5.003), (I-746)+(1.033)+(5.004), (I-746)+(1.033)+(5.005), (I-746)+(1.033)+(5.006), (I-746)+(1.033)+(5.007), (I-746)+(1.033)+(5.008), (I-746)+(1.033)+(5.009), (I-746)+(1.033)+(5.010), (I-746)+(1.033)+(5.011), (I-746)+(1.033)+(5.012), (I-746)+(1.033)+(5.013), (I-746)+(1.033)+(5.014), (I-746)+(1.033)+(5.015), (I-746)+(1.033)+(5.016), (I-746)+(1.033)+(5.017), (I-746)+(1.033)+(5.018), (I-746)+(1.033)+(5.019), (I-746)+(1.033)+(5.020), (I-746)+(1.033)+(5.021), (I-746)+(1.033)+(5.022), (I-746)+(1.033)+(5.023), (I-746)+(1.033)+(6.001), (I-746)+(1.033)+(6.002), (I-746)+(1.033)+(6.003), (I-746)+(1.033)+(6.004), (I-746)+(1.033)+(7.001), (I-746)+(1.033)+(7.002), (I-746)+(1.033)+(7.003), (I-746)+(1.033)+(7.004), (I-746)+(1.033)+(7.005), (I-746)+(1.033)+(7.006), (I-746)+(1.033)+(9.001), (I-746)+(1.033)+(9.002), (I-746)+(1.033)+(9.003), (I-746)+(1.033)+(9.004), (I-746)+(1.033)+(9.005), (I-746)+(1.033)+(9.006), (I-746)+(1.033)+(9.007), (I-746)+(1.033)+(9.008), (I-746)+(1.033)+(9.009), (I-746)+(1.033)+(14.001), (I-746)+(1.033)+(14.002), (I-746)+(1.033)+(15.008), (I-746)+(1.033)+(15.011), (I-746)+(1.033)+(15.012), (I-746)+(1.033)+(15.016), (I-746)+(1.033)+(15.025), (I-746)+(1.033)+(15.027), (I-746)+(1.033)+(15.047), (I-746)+(1.033)+(15.063), (I-746)+(1.033)+(15.064), (I-746)+(1.033)+(16.001), (I-746)+(1.033)+(16.002), (I-746)+(1.033)+(16.003), (I-746)+(1.033)+(16.004), (I-746)+(1.033)+(16.005), (I-746)+(1.033)+(16.006), (I-746)+(1.033)+(16.007), (I-746)+(1.033)+(16.008), (I-746)+(1.033)+(17.001), (I-746)+(1.033)+(17.002), (I-746)+(1.033)+(17.003), (I-746)+(1.033)+(17.004), (I-746)+(1.033)+(17.005), (I-746)+(1.033)+(17.006), (I-746)+(1.033)+(17.007), (I-746)+(1.033)+(17.008), (I-746)+(1.033)+(17.009), (I-746)+(1.033)+(17.010), (I-746)+(1.033)+(17.011), (I-746)+(1.033)+(17.012), (I-746)+(1.033)+(18.001),

(I-746)+(1.034)+(1.035), (I-746)+(1.034)+(1.036), (I-746)+(1.034)+(1.037), (I-746)+(1.034)+(1.038), (I-746)+(1.034)+(1.039), (I-746)+(1.034)+(1.040), (I-746)+(1.034)+(1.041), (I-746)+(1.034)+(1.042), (I-746)+(1.034)+(1.043), (I-746)+(1.034)+(1.044), (I-746)+(1.034)+(1.045), (I-746)+(1.034)+(1.046), (I-746)+(1.034)+(1.047), (I-746)+(1.034)+(1.048), (I-746)+(1.034)+(1.049), (I-746)+(1.034)+(1.050), (I-746)+(1.034)+(1.051), (I-746)+(1.034)+(1.052), (I-746)+(1.034)+(1.053), (I-746)+(1.034)+(1.054), (I-746)+(1.034)+(1.055), (I-746)+(1.034)+(1.056), (I-746)+(1.034)+(1.057), (I-746)+(1.034)+(1.058), (I-746)+(1.034)+(1.059), (I-746)+(1.034)+(1.060), (I-746)+(1.034)+(1.061), (I-746)+(1.034)+(1.062), (I-746)+(1.034)+(1.063), (I-746)+(1.034)+(1.064), (I-746)+(1.034)+(1.065), (I-746)+(1.034)+(1.066), (I-746)+(1.034)+(1.067), (I-746)+(1.034)+(1.068), (I-746)+(1.034)+(1.069), (I-746)+(1.034)+(1.070), (I-746)+(1.034)+(1.071), (I-746)+(1.034)+(1.072), (I-746)+(1.034)+(1.073), (I-746)+(1.034)+(1.074), (I-746)+(1.034)+(1.075), (I-746)+(1.034)+(1.076), (I-746)+(1.034)+(1.077), (I-746)+(1.034)+(1.078), (I-746)+(1.034)+(1.079), (I-746)+(1.034)+(1.080), (I-746)+(1.034)+(1.081), (I-746)+(1.034)+(1.082), (I-746)+(1.034)+(1.083), (I-746)+(1.034)+(1.084), (I-746)+(1.034)+(1.085), (I-746)+(1.034)+(1.086), (I-746)+(1.034)+(1.087), (I-746)+(1.034)+(1.088), (I-746)+(1.034)+(1.089), (I-746)+(1.034)+(1.090), (I-746)+(1.034)+(1.091), (I-746)+(1.034)+(1.092), (I-746)+(1.034)+(2.001), (I-746)+(1.034)+(2.002), (I-746)+(1.034)+(2.003), (I-746)+(1.034)+(2.004), (I-746)+(1.034)+(2.005), (I-746)+(1.034)+(2.006), (I-746)+(1.034)+(2.007), (I-746)+(1.034)+(2.008), (I-746)+(1.034)+(2.009), (I-746)+(1.034)+(2.010), (I-746)+(1.034)+(2.011), (I-746)+(1.034)+(2.012), (I-746)+(1.034)+(2.013), (I-746)+(1.034)+(2.014), (I-746)+(1.034)+(2.015), (I-746)+(1.034)+(2.016), (I-746)+(1.034)+(2.017), (I-746)+(1.034)+(2.018), (I-746)+(1.034)+(2.019), (I-746)+(1.034)+(2.020), (I-746)+(1.034)+(2.021), (I-746)+(1.034)+(2.022), (I-746)+(1.034)+(2.023), (I-746)+(1.034)+(2.024), (I-746)+(1.034)+(2.025), (I-746)+(1.034)+(2.026), (I-746)+(1.034)+(2.027), (I-746)+(1.034)+(2.028), (I-746)+(1.034)+(2.029), (I-746)+(1.034)+(2.030), (I-746)+(1.034)+(2.031), (I-746)+(1.034)+(2.032), (I-746)+(1.034)+(2.033), (I-746)+(1.034)+(2.034), (I-746)+(1.034)+(2.035), (I-746)+(1.034)+(2.036), (I-746)+(1.034)+(2.037), (I-746)+(1.034)+(2.038), (I-746)+(1.034)+(2.039), (I-746)+(1.034)+(2.040), (I-746)+(1.034)+(2.041), (I-746)+(1.034)+(2.042), (I-746)+(1.034)+(2.043), (I-746)+(1.034)+(2.044), (I-746)+(1.034)+(2.045), (I-746)+(1.034)+(2.046), (I-746)+(1.034)+(2.047), (I-746)+(1.034)+(2.048), (I-746)+(1.034)+(2.049), (I-746)+(1.034)+(2.050), (I-746)+(1.034)+(2.051), (I-746)+(1.034)+(2.052), (I-746)+(1.034)+(2.053), (I-746)+(1.034)+(2.054), (I-746)+(1.034)+(2.055), (I-746)+(1.034)+(2.056), (I-746)+(1.034)+(2.057), (I-746)+(1.034)+(2.058), (I-746)+(1.034)+(2.059), (I-746)+(1.034)+(3.001), (I-746)+(1.034)+(3.002), (I-746)+(1.034)+(3.003), (I-746)+(1.034)+(3.004), (I-746)+(1.034)+(3.005), (I-746)+(1.034)+(3.006), (I-746)+(1.034)+(3.007), (I-746)+(1.034)+(3.008), (I-746)+(1.034)+(3.009), (I-746)+(1.034)+(3.010), (I-746)+(1.034)+(3.011), (I-746)+(1.034)+(3.012), (I-746)+(1.034)+(3.013), (I-746)+(1.034)+(3.014), (I-746)+(1.034)+(3.015), (I-746)+(1.034)+(3.016), (I-746)+(1.034)+(3.017), (I-746)+(1.034)+(3.018), (I-746)+(1.034)+(3.019), (I-746)+(1.034)+(3.020), (I-746)+(1.034)+(3.021), (I-746)+(1.034)+(3.022), (I-746)+(1.034)+(3.023), (I-746)+(1.034)+(3.024), (I-746)+(1.034)+(3.025), (I-746)+(1.034)+(3.026), (I-746)+(1.034)+(3.027), (I-746)+(1.034)+(3.028), (I-746)+(1.034)+(3.029), (I-746)+(1.034)+(3.030), (I-746)+(1.034)+(3.031), (I-746)+(1.034)+(5.001), (I-746)+(1.034)+(5.002), (I-746)+(1.034)+(5.003), (I-746)+(1.034)+(5.004), (I-746)+(1.034)+(5.005), (I-746)+(1.034)+(5.006), (I-746)+(1.034)+(5.007), (I-746)+(1.034)+(5.008), (I-746)+(1.034)+(5.009), (I-746)+(1.034)+(5.010), (I-746)+(1.034)+(5.011), (I-746)+(1.034)+(5.012), (I-746)+(1.034)+(5.013), (I-746)+(1.034)+(5.014), (I-746)+(1.034)+(5.015), (I-746)+(1.034)+(5.016), (I-746)+(1.034)+(5.017), (I-746)+(1.034)+(5.018), (I-746)+(1.034)+(5.019), (I-746)+(1.034)+(5.020), (I-746)+(1.034)+(5.021), (I-746)+(1.034)+(5.022), (I-746)+(1.034)+(5.023), (I-746)+(1.034)+(6.001), (I-746)+(1.034)+(6.002), (I-746)+(1.034)+(6.003), (I-746)+(1.034)+(6.004), (I-746)+(1.034)+(7.001), (I-746)+(1.034)+(7.002), (I-746)+(1.034)+(7.003), (I-746)+(1.034)+(7.004), (I-746)+(1.034)+(7.005), (I-746)+(1.034)+(7.006), (I-746)+(1.034)+(9.001), (I-746)+(1.034)+(9.002), (I-746)+(1.034)+(9.003), (I-746)+(1.034)+(9.004), (I-746)+(1.034)+(9.005), (I-746)+(1.034)+(9.006), (I-746)+(1.034)+(9.007), (I-746)+(1.034)+(9.008), (I-746)+(1.034)+(9.009), (I-746)+(1.034)+(14.001), (I-746)+(1.034)+(14.002), (I-746)+(1.034)+(15.008), (I-746)+(1.034)+(15.011), (I-746)+(1.034)+(15.012), (I-746)+(1.034)+(15.016), (I-746)+(1.034)+(15.025), (I-746)+(1.034)+(15.027), (I-746)+(1.034)+(15.047), (I-746)+(1.034)+(15.063), (I-746)+(1.034)+(15.064), (I-746)+(1.034)+(16.001), (I-746)+(1.034)+(16.002), (I-746)+(1.034)+(16.003), (I-746)+(1.034)+(16.004), (I-746)+(1.034)+(16.005), (I-746)+(1.034)+(16.006), (I-746)+(1.034)+(16.007), (I-746)+(1.034)+(16.008), (I-746)+(1.034)+(17.001), (I-746)+(1.034)+(17.002), (I-746)+(1.034)+(17.003), (I-746)+(1.034)+(17.004), (I-746)+(1.034)+(17.005), (I-746)+(1.034)+(17.006), (I-746)+(1.034)+(17.007), (I-746)+(1.034)+(17.008), (I-746)+(1.034)+(17.009), (I-746)+(1.034)+(17.010), (I-746)+(1.034)+(17.011), (I-746)+(1.034)+(17.012), (I-746)+(1.034)+(18.001),

(I-746)+(1.035)+(1.036), (I-746)+(1.035)+(1.037), (I-746)+(1.035)+(1.038), (I-746)+(1.035)+(1.039), (I-746)+(1.035)+(1.040), (I-746)+(1.035)+(1.041), (I-746)+(1.035)+(1.042), (I-746)+(1.035)+(1.043), (I-746)+(1.035)+(1.044), (I-746)+(1.035)+(1.045), (I-746)+(1.035)+(1.046), (I-746)+(1.035)+(1.047), (I-746)+(1.035)+(1.048), (I-746)+(1.035)+(1.049), (I-746)+(1.035)+(1.050), (I-746)+(1.035)+(1.051), (I-746)+(1.035)+(1.052), (I-746)+(1.035)+(1.053), (I-746)+(1.035)+(1.054), (I-746)+(1.035)+(1.055), (I-746)+(1.035)+(1.056), (I-746)+(1.035)+(1.057), (I-746)+(1.035)+(1.058), (I-746)+(1.035)+(1.059), (I-746)+(1.035)+(1.060), (I-746)+(1.035)+(1.061), (I-746)+(1.035)+(1.062), (I-746)+(1.035)+(1.063), (I-746)+(1.035)+(1.064), (I-746)+(1.035)+(1.065), (I-746)+(1.035)+(1.066), (I-746)+(1.035)+(1.067), (I-746)+(1.035)+(1.068), (I-746)+(1.035)+(1.069), (I-746)+(1.035)+(1.070), (I-746)+(1.035)+(1.071), (I-746)+(1.035)+(1.072), (I-746)+(1.035)+(1.073), (I-746)+(1.035)+(1.074), (I-746)+(1.035)+(1.075), (I-746)+(1.035)+(1.076), (I-746)+(1.035)+(1.077), (I-746)+(1.035)+(1.078), (I-746)+(1.035)+(1.079), (I-746)+(1.035)+(1.080), (I-746)+(1.035)+(1.081), (I-746)+(1.035)+(1.082), (I-746)+(1.035)+(1.083), (I-746)+(1.035)+(1.084), (I-746)+(1.035)+(1.085), (I-746)+(1.035)+(1.086), (I-746)+(1.035)+(1.087), (I-746)+(1.035)+(1.088), (I-746)+(1.035)+(1.089), (I-746)+(1.035)+(1.090), (I-746)+(1.035)+(1.091), (I-746)+(1.035)+(1.092), (I-746)+(1.035)+(2.001), (I-746)+(1.035)+(2.002), (I-746)+(1.035)+(2.003), (I-746)+(1.035)+(2.004), (I-746)+(1.035)+(2.005), (I-746)+(1.035)+(2.006), (I-746)+(1.035)+(2.007), (I-746)+(1.035)+(2.008), (I-746)+(1.035)+(2.009), (I-746)+(1.035)+(2.010), (I-746)+(1.035)+(2.011), (I-746)+(1.035)+(2.012), (I-746)+(1.035)+(2.013), (I-746)+(1.035)+(2.014), (I-746)+(1.035)+(2.015), (I-746)+(1.035)+(2.016), (I-746)+(1.035)+(2.017), (I-746)+(1.035)+(2.018), (I-746)+(1.035)+(2.019), (I-746)+(1.035)+(2.020), (I-746)+(1.035)+(2.021), (I-746)+(1.035)+(2.022), (I-746)+(1.035)+(2.023), (I-746)+(1.035)+(2.024), (I-746)+(1.035)+(2.025), (I-746)+(1.035)+(2.026), (I-746)+(1.035)+(2.027), (I-746)+(1.035)+(2.028), (I-746)+(1.035)+(2.029), (I-746)+(1.035)+(2.030), (I-746)+(1.035)+(2.031), (I-746)+(1.035)+(2.032), (I-746)+(1.035)+(2.033), (I-746)+(1.035)+(2.034), (I-746)+(1.035)+(2.035), (I-746)+(1.035)+(2.036), (I-746)+(1.035)+(2.037), (I-746)+(1.035)+(2.038), (I-746)+(1.035)+(2.039), (I-746)+(1.035)+(2.040), (I-746)+(1.035)+(2.041), (I-746)+(1.035)+(2.042), (I-746)+(1.035)+(2.043), (I-746)+(1.035)+(2.044), (I-746)+(1.035)+(2.045), (I-746)+(1.035)+(2.046), (I-746)+(1.035)+(2.047), (I-746)+(1.035)+(2.048), (I-746)+(1.035)+(2.049), (I-746)+(1.035)+(2.050), (I-746)+(1.035)+(2.051), (I-746)+(1.035)+(2.052), (I-746)+(1.035)+(2.053), (I-746)+(1.035)+(2.054), (I-746)+(1.035)+(2.055), (I-746)+(1.035)+(2.056), (I-746)+(1.035)+(2.057), (I-746)+(1.035)+(2.058), (I-746)+(1.035)+(2.059), (I-746)+(1.035)+(3.001), (I-746)+(1.035)+(3.002), (I-746)+(1.035)+(3.003), (I-746)+(1.035)+(3.004), (I-746)+(1.035)+(3.005), (I-746)+(1.035)+(3.006), (I-746)+(1.035)+(3.007), (I-746)+(1.035)+(3.008), (I-746)+(1.035)+(3.009), (I-746)+(1.035)+(3.010), (I-746)+(1.035)+(3.011), (I-746)+(1.035)+(3.012), (I-746)+(1.035)+(3.013), (I-746)+(1.035)+(3.014), (I-746)+(1.035)+(3.015), (I-746)+(1.035)+(3.016), (I-746)+(1.035)+(3.017), (I-746)+(1.035)+(3.018), (I-746)+(1.035)+(3.019), (I-746)+(1.035)+(3.020), (I-746)+(1.035)+(3.021), (I-746)+(1.035)+(3.022), (I-746)+(1.035)+(3.023), (I-746)+(1.035)+(3.024), (I-746)+(1.035)+(3.025), (I-746)+(1.035)+(3.026), (I-746)+(1.035)+(3.027), (I-746)+(1.035)+(3.028), (I-746)+(1.035)+(3.029), (I-746)+(1.035)+(3.030), (I-746)+(1.035)+(3.031), (I-746)+(1.035)+(5.001), (I-746)+(1.035)+(5.002), (I-746)+(1.035)+(5.003), (I-746)+(1.035)+(5.004), (I-746)+(1.035)+(5.005), (I-746)+(1.035)+(5.006), (I-746)+(1.035)+(5.007), (I-746)+(1.035)+(5.008), (I-746)+(1.035)+(5.009), (I-746)+(1.035)+(5.010), (I-746)+(1.035)+(5.011), (I-746)+(1.035)+(5.012), (I-746)+(1.035)+(5.013), (I-746)+(1.035)+(5.014), (I-746)+(1.035)+(5.015), (I-746)+(1.035)+(5.016), (I-746)+(1.035)+(5.017), (I-746)+(1.035)+(5.018), (I-746)+(1.035)+(5.019), (I-746)+(1.035)+(5.020), (I-746)+(1.035)+(5.021), (I-746)+(1.035)+(5.022), (I-746)+(1.035)+(5.023), (I-746)+(1.035)+(6.001), (I-746)+(1.035)+(6.002), (I-746)+(1.035)+(6.003), (I-746)+(1.035)+(6.004), (I-746)+(1.035)+(7.001), (I-746)+(1.035)+(7.002), (I-746)+(1.035)+(7.003), (I-746)+(1.035)+(7.004), (I-746)+(1.035)+(7.005), (I-746)+(1.035)+(7.006), (I-746)+(1.035)+(9.001), (I-746)+(1.035)+(9.002), (I-746)+(1.035)+(9.003), (I-746)+(1.035)+(9.004), (I-746)+(1.035)+(9.005), (I-746)+(1.035)+(9.006), (I-746)+(1.035)+(9.007), (I-746)+(1.035)+(9.008), (I-746)+(1.035)+(9.009), (I-746)+(1.035)+(14.001), (I-746)+(1.035)+(14.002), (I-746)+(1.035)+(15.008), (I-746)+(1.035)+(15.011), (I-746)+(1.035)+(15.012), (I-746)+(1.035)+(15.016), (I-746)+(1.035)+(15.025), (I-746)+(1.035)+(15.027), (I-746)+(1.035)+(15.047), (I-746)+(1.035)+(15.063), (I-746)+(1.035)+(15.064), (I-746)+(1.035)+(16.001), (I-746)+(1.035)+(16.002), (I-746)+(1.035)+(16.003), (I-746)+(1.035)+(16.004), (I-746)+(1.035)+(16.005), (I-746)+(1.035)+(16.006), (I-746)+(1.035)+(16.007), (I-746)+(1.035)+(16.008), (I-746)+(1.035)+(17.001), (I-746)+(1.035)+(17.002), (I-746)+(1.035)+(17.003), (I-746)+(1.035)+(17.004), (I-746)+(1.035)+(17.005), (I-746)+(1.035)+(17.006), (I-746)+(1.035)+(17.007), (I-746)+(1.035)+(17.008), (I-746)+(1.035)+(17.009), (I-746)+(1.035)+(17.010), (I-746)+(1.035)+(17.011), (I-746)+(1.035)+(17.012), (I-746)+(1.035)+(18.001),

(I-746)+(1.036)+(1.037), (I-746)+(1.036)+(1.038), (I-746)+(1.036)+(1.039), (I-746)+(1.036)+(1.040), (I-746)+(1.036)+(1.041), (I-746)+(1.036)+(1.042), (I-746)+(1.036)+(1.043), (I-746)+(1.036)+(1.044), (I-746)+(1.036)+(1.045), (I-746)+(1.036)+(1.046), (I-746)+(1.036)+(1.047), (I-746)+(1.036)+(1.048), (I-746)+(1.036)+(1.049), (I-746)+(1.036)+(1.050), (I-746)+(1.036)+(1.051), (I-746)+(1.036)+(1.052), (I-746)+(1.036)+(1.053), (I-746)+(1.036)+(1.054), (I-746)+(1.036)+(1.055), (I-746)+(1.036)+(1.056), (I-746)+(1.036)+(1.057), (I-746)+(1.036)+(1.058), (I-746)+(1.036)+(1.059), (I-746)+(1.036)+(1.060), (I-746)+(1.036)+(1.061), (I-746)+(1.036)+(1.062), (I-746)+(1.036)+(1.063), (I-746)+(1.036)+(1.064), (I-746)+(1.036)+(1.065), (I-746)+(1.036)+(1.066), (I-746)+(1.036)+(1.067), (I-746)+(1.036)+(1.068), (I-746)+(1.036)+(1.069), (I-746)+(1.036)+(1.070), (I-746)+(1.036)+(1.071), (I-746)+(1.036)+(1.072), (I-746)+(1.036)+(1.073), (I-746)+(1.036)+(1.074), (I-746)+(1.036)+(1.075), (I-746)+(1.036)+(1.076), (I-746)+(1.036)+(1.077), (I-746)+(1.036)+(1.078), (I-746)+(1.036)+(1.079), (I-746)+(1.036)+(1.080), (I-746)+(1.036)+(1.081), (I-746)+(1.036)+(1.082), (I-746)+(1.036)+(1.083), (I-746)+(1.036)+(1.084), (I-746)+(1.036)+(1.085), (I-746)+(1.036)+(1.086), (I-746)+(1.036)+(1.087), (I-746)+(1.036)+(1.088), (I-746)+(1.036)+(1.089), (I-746)+(1.036)+(1.090), (I-746)+(1.036)+(1.091), (I-746)+(1.036)+(1.092), (I-746)+(1.036)+(2.001), (I-746)+(1.036)+(2.002), (I-746)+(1.036)+(2.003), (I-746)+(1.036)+(2.004), (I-746)+(1.036)+(2.005), (I-746)+(1.036)+(2.006), (I-746)+(1.036)+(2.007), (I-746)+(1.036)+(2.008), (I-746)+(1.036)+(2.009), (I-746)+(1.036)+(2.010), (I-746)+(1.036)+(2.011), (I-746)+(1.036)+(2.012), (I-746)+(1.036)+(2.013), (I-746)+(1.036)+(2.014), (I-746)+(1.036)+(2.015), (I-746)+(1.036)+(2.016), (I-746)+(1.036)+(2.017), (I-746)+(1.036)+(2.018), (I-746)+(1.036)+(2.019), (I-746)+(1.036)+(2.020), (I-746)+(1.036)+(2.021), (I-746)+(1.036)+(2.022), (I-746)+(1.036)+(2.023), (I-746)+(1.036)+(2.024), (I-746)+(1.036)+(2.025), (I-746)+(1.036)+(2.026), (I-746)+(1.036)+(2.027), (I-746)+(1.036)+(2.028), (I-746)+(1.036)+(2.029), (I-746)+(1.036)+(2.030), (I-746)+(1.036)+(2.031), (I-746)+(1.036)+(2.032), (I-746)+(1.036)+(2.033), (I-746)+(1.036)+(2.034), (I-746)+(1.036)+(2.035), (I-746)+(1.036)+(2.036), (I-746)+(1.036)+(2.037), (I-746)+(1.036)+(2.038), (I-746)+(1.036)+(2.039), (I-746)+(1.036)+(2.040), (I-746)+(1.036)+(2.041), (I-746)+(1.036)+(2.042), (I-746)+(1.036)+(2.043), (I-746)+(1.036)+(2.044), (I-746)+(1.036)+(2.045), (I-746)+(1.036)+(2.046), (I-746)+(1.036)+(2.047), (I-746)+(1.036)+(2.048), (I-746)+(1.036)+(2.049), (I-746)+(1.036)+(2.050), (I-746)+(1.036)+(2.051), (I-746)+(1.036)+(2.052), (I-746)+(1.036)+(2.053), (I-746)+(1.036)+(2.054), (I-746)+(1.036)+(2.055), (I-746)+(1.036)+(2.056), (I-746)+(1.036)+(2.057), (I-746)+(1.036)+(2.058), (I-746)+(1.036)+(2.059), (I-746)+(1.036)+(3.001), (I-746)+(1.036)+(3.002), (I-746)+(1.036)+(3.003), (I-746)+(1.036)+(3.004), (I-746)+(1.036)+(3.005), (I-746)+(1.036)+(3.006), (I-746)+(1.036)+(3.007), (I-746)+(1.036)+(3.008), (I-746)+(1.036)+(3.009), (I-746)+(1.036)+(3.010), (I-746)+(1.036)+(3.011), (I-746)+(1.036)+(3.012), (I-746)+(1.036)+(3.013), (I-746)+(1.036)+(3.014), (I-746)+(1.036)+(3.015), (I-746)+(1.036)+(3.016), (I-746)+(1.036)+(3.017), (I-746)+(1.036)+(3.018), (I-746)+(1.036)+(3.019), (I-746)+(1.036)+(3.020), (I-746)+(1.036)+(3.021), (I-746)+(1.036)+(3.022), (I-746)+(1.036)+(3.023), (I-746)+(1.036)+(3.024), (I-746)+(1.036)+(3.025), (I-746)+(1.036)+(3.026), (I-746)+(1.036)+(3.027), (I-746)+(1.036)+(3.028), (I-746)+(1.036)+(3.029), (I-746)+(1.036)+(3.030), (I-746)+(1.036)+(3.031), (I-746)+(1.036)+(5.001), (I-746)+(1.036)+(5.002), (I-746)+(1.036)+(5.003), (I-746)+(1.036)+(5.004), (I-746)+(1.036)+(5.005), (I-746)+(1.036)+(5.006), (I-746)+(1.036)+(5.007), (I-746)+(1.036)+(5.008), (I-746)+(1.036)+(5.009), (I-746)+(1.036)+(5.010), (I-746)+(1.036)+(5.011), (I-746)+(1.036)+(5.012), (I-746)+(1.036)+(5.013), (I-746)+(1.036)+(5.014), (I-746)+(1.036)+(5.015), (I-746)+(1.036)+(5.016), (I-746)+(1.036)+(5.017), (I-746)+(1.036)+(5.018), (I-746)+(1.036)+(5.019), (I-746)+(1.036)+(5.020), (I-746)+(1.036)+(5.021), (I-746)+(1.036)+(5.022), (I-746)+(1.036)+(5.023), (I-746)+(1.036)+(6.001), (I-746)+(1.036)+(6.002), (I-746)+(1.036)+(6.003), (I-746)+(1.036)+(6.004), (I-746)+(1.036)+(7.001), (I-746)+(1.036)+(7.002), (I-746)+(1.036)+(7.003), (I-746)+(1.036)+(7.004), (I-746)+(1.036)+(7.005), (I-746)+(1.036)+(7.006), (I-746)+(1.036)+(9.001), (I-746)+(1.036)+(9.002), (I-746)+(1.036)+(9.003), (I-746)+(1.036)+(9.004), (I-746)+(1.036)+(9.005), (I-746)+(1.036)+(9.006), (I-746)+(1.036)+(9.007), (I-746)+(1.036)+(9.008), (I-746)+(1.036)+(9.009), (I-746)+(1.036)+(14.001), (I-746)+(1.036)+(14.002), (I-746)+(1.036)+(15.008), (I-746)+(1.036)+(15.011), (I-746)+(1.036)+(15.012), (I-746)+(1.036)+(15.016), (I-746)+(1.036)+(15.025), (I-746)+(1.036)+(15.027), (I-746)+(1.036)+(15.047), (I-746)+(1.036)+(15.063), (I-746)+(1.036)+(15.064), (I-746)+(1.036)+(16.001), (I-746)+(1.036)+(16.002), (I-746)+(1.036)+(16.003), (I-746)+(1.036)+(16.004), (I-746)+(1.036)+(16.005), (I-746)+(1.036)+(16.006), (I-746)+(1.036)+(16.007), (I-746)+(1.036)+(16.008), (I-746)+(1.036)+(17.001), (I-746)+(1.036)+(17.002), (I-746)+(1.036)+(17.003), (I-746)+(1.036)+(17.004), (I-746)+(1.036)+(17.005), (I-746)+(1.036)+(17.006), (I-746)+(1.036)+(17.007), (I-746)+(1.036)+(17.008), (I-746)+(1.036)+(17.009), (I-746)+(1.036)+(17.010), (I-746)+(1.036)+(17.011), (I-746)+(1.036)+(17.012), (I-746)+(1.036)+(18.001),

(I-746)+(1.037)+(1.038), (I-746)+(1.037)+(1.039), (I-746)+(1.037)+(1.040), (I-746)+(1.037)+(1.041), (I-746)+(1.037)+(1.042), (I-746)+(1.037)+(1.043), (I-746)+(1.037)+(1.044), (I-746)+(1.037)+(1.045), (I-746)+(1.037)+(1.046), (I-746)+(1.037)+(1.047), (I-746)+(1.037)+(1.048), (I-746)+(1.037)+(1.049), (I-746)+(1.037)+(1.050), (I-746)+(1.037)+(1.051), (I-746)+(1.037)+(1.052), (I-746)+(1.037)+(1.053), (I-746)+(1.037)+(1.054), (I-746)+(1.037)+(1.055), (I-746)+(1.037)+(1.056), (I-746)+(1.037)+(1.057), (I-746)+(1.037)+(1.058), (I-746)+(1.037)+(1.059), (I-746)+(1.037)+(1.060), (I-746)+(1.037)+(1.061), (I-746)+(1.037)+(1.062), (I-746)+(1.037)+(1.063), (I-746)+(1.037)+(1.064), (I-746)+(1.037)+(1.065), (I-746)+(1.037)+(1.066), (I-746)+(1.037)+(1.067), (I-746)+(1.037)+(1.068), (I-746)+(1.037)+(1.069), (I-746)+(1.037)+(1.070), (I-746)+(1.037)+(1.071), (I-746)+(1.037)+(1.072), (I-746)+(1.037)+(1.073), (I-746)+(1.037)+(1.074), (I-746)+(1.037)+(1.075), (I-746)+(1.037)+(1.076), (I-746)+(1.037)+(1.077), (I-746)+(1.037)+(1.078), (I-746)+(1.037)+(1.079), (I-746)+(1.037)+(1.080), (I-746)+(1.037)+(1.081), (I-746)+(1.037)+(1.082), (I-746)+(1.037)+(1.083), (I-746)+(1.037)+(1.084), (I-746)+(1.037)+(1.085), (I-746)+(1.037)+(1.086), (I-746)+(1.037)+(1.087), (I-746)+(1.037)+(1.088), (I-746)+(1.037)+(1.089), (I-746)+(1.037)+(1.090), (I-746)+(1.037)+(1.091), (I-746)+(1.037)+(1.092), (I-746)+(1.037)+(2.001), (I-746)+(1.037)+(2.002), (I-746)+(1.037)+(2.003), (I-746)+(1.037)+(2.004), (I-746)+(1.037)+(2.005), (I-746)+(1.037)+(2.006), (I-746)+(1.037)+(2.007), (I-746)+(1.037)+(2.008), (I-746)+(1.037)+(2.009), (I-746)+(1.037)+(2.010), (I-746)+(1.037)+(2.011), (I-746)+(1.037)+(2.012), (I-746)+(1.037)+(2.013), (I-746)+(1.037)+(2.014), (I-746)+(1.037)+(2.015), (I-746)+(1.037)+(2.016), (I-746)+(1.037)+(2.017), (I-746)+(1.037)+(2.018), (I-746)+(1.037)+(2.019), (I-746)+(1.037)+(2.020), (I-746)+(1.037)+(2.021), (I-746)+(1.037)+(2.022), (I-746)+(1.037)+(2.023), (I-746)+(1.037)+(2.024), (I-746)+(1.037)+(2.025), (I-746)+(1.037)+(2.026), (I-746)+(1.037)+(2.027), (I-746)+(1.037)+(2.028), (I-746)+(1.037)+(2.029), (I-746)+(1.037)+(2.030), (I-746)+(1.037)+(2.031), (I-746)+(1.037)+(2.032), (I-746)+(1.037)+(2.033), (I-746)+(1.037)+(2.034), (I-746)+(1.037)+(2.035), (I-746)+(1.037)+(2.036), (I-746)+(1.037)+(2.037), (I-746)+(1.037)+(2.038), (I-746)+(1.037)+(2.039), (I-746)+(1.037)+(2.040), (I-746)+(1.037)+(2.041), (I-746)+(1.037)+(2.042), (I-746)+(1.037)+(2.043), (I-746)+(1.037)+(2.044), (I-746)+(1.037)+(2.045), (I-746)+(1.037)+(2.046), (I-746)+(1.037)+(2.047), (I-746)+(1.037)+(2.048), (I-746)+(1.037)+(2.049), (I-746)+(1.037)+(2.050), (I-746)+(1.037)+(2.051), (I-746)+(1.037)+(2.052), (I-746)+(1.037)+(2.053), (I-746)+(1.037)+(2.054), (I-746)+(1.037)+(2.055), (I-746)+(1.037)+(2.056), (I-746)+(1.037)+(2.057), (I-746)+(1.037)+(2.058), (I-746)+(1.037)+(2.059), (I-746)+(1.037)+(3.001), (I-746)+(1.037)+(3.002), (I-746)+(1.037)+(3.003), (I-746)+(1.037)+(3.004), (I-746)+(1.037)+(3.005), (I-746)+(1.037)+(3.006), (I-746)+(1.037)+(3.007), (I-746)+(1.037)+(3.008), (I-746)+(1.037)+(3.009), (I-746)+(1.037)+(3.010), (I-746)+(1.037)+(3.011), (I-746)+(1.037)+(3.012), (I-746)+(1.037)+(3.013), (I-746)+(1.037)+(3.014), (I-746)+(1.037)+(3.015), (I-746)+(1.037)+(3.016), (I-746)+(1.037)+(3.017), (I-746)+(1.037)+(3.018), (I-746)+(1.037)+(3.019), (I-746)+(1.037)+(3.020), (I-746)+(1.037)+(3.021), (I-746)+(1.037)+(3.022), (I-746)+(1.037)+(3.023), (I-746)+(1.037)+(3.024), (I-746)+(1.037)+(3.025), (I-746)+(1.037)+(3.026), (I-746)+(1.037)+(3.027), (I-746)+(1.037)+(3.028), (I-746)+(1.037)+(3.029), (I-746)+(1.037)+(3.030), (I-746)+(1.037)+(3.031), (I-746)+(1.037)+(5.001), (I-746)+(1.037)+(5.002), (I-746)+(1.037)+(5.003), (I-746)+(1.037)+(5.004), (I-746)+(1.037)+(5.005), (I-746)+(1.037)+(5.006), (I-746)+(1.037)+(5.007), (I-746)+(1.037)+(5.008), (I-746)+(1.037)+(5.009), (I-746)+(1.037)+(5.010), (I-746)+(1.037)+(5.011), (I-746)+(1.037)+(5.012), (I-746)+(1.037)+(5.013), (I-746)+(1.037)+(5.014), (I-746)+(1.037)+(5.015), (I-746)+(1.037)+(5.016), (I-746)+(1.037)+(5.017), (I-746)+(1.037)+(5.018), (I-746)+(1.037)+(5.019), (I-746)+(1.037)+(5.020), (I-746)+(1.037)+(5.021), (I-746)+(1.037)+(5.022), (I-746)+(1.037)+(5.023), (I-746)+(1.037)+(6.001), (I-746)+(1.037)+(6.002), (I-746)+(1.037)+(6.003), (I-746)+(1.037)+(6.004), (I-746)+(1.037)+(7.001), (I-746)+(1.037)+(7.002), (I-746)+(1.037)+(7.003), (I-746)+(1.037)+(7.004), (I-746)+(1.037)+(7.005), (I-746)+(1.037)+(7.006), (I-746)+(1.037)+(9.001), (I-746)+(1.037)+(9.002), (I-746)+(1.037)+(9.003), (I-746)+(1.037)+(9.004), (I-746)+(1.037)+(9.005), (I-746)+(1.037)+(9.006), (I-746)+(1.037)+(9.007), (I-746)+(1.037)+(9.008), (I-746)+(1.037)+(9.009), (I-746)+(1.037)+(14.001), (I-746)+(1.037)+(14.002), (I-746)+(1.037)+(15.008), (I-746)+(1.037)+(15.011), (I-746)+(1.037)+(15.012), (I-746)+(1.037)+(15.016), (I-746)+(1.037)+(15.025), (I-746)+(1.037)+(15.027), (I-746)+(1.037)+(15.047), (I-746)+(1.037)+(15.063), (I-746)+(1.037)+(15.064), (I-746)+(1.037)+(16.001), (I-746)+(1.037)+(16.002), (I-746)+(1.037)+(16.003), (I-746)+(1.037)+(16.004), (I-746)+(1.037)+(16.005), (I-746)+(1.037)+(16.006), (I-746)+(1.037)+(16.007), (I-746)+(1.037)+(16.008), (I-746)+(1.037)+(17.001), (I-746)+(1.037)+(17.002), (I-746)+(1.037)+(17.003), (I-746)+(1.037)+(17.004), (I-746)+(1.037)+(17.005), (I-746)+(1.037)+(17.006), (I-746)+(1.037)+(17.007), (I-746)+(1.037)+(17.008), (I-746)+(1.037)+(17.009), (I-746)+(1.037)+(17.010), (I-746)+(1.037)+(17.011), (I-746)+(1.037)+(17.012), (I-746)+(1.037)+(18.001),

(I-746)+(1.038)+(1.039), (I-746)+(1.038)+(1.040), (I-746)+(1.038)+(1.041), (I-746)+(1.038)+(1.042), (I-746)+(1.038)+(1.043), (I-746)+(1.038)+(1.044), (I-746)+(1.038)+(1.045), (I-746)+(1.038)+(1.046), (I-746)+(1.038)+(1.047), (I-746)+(1.038)+(1.048), (I-746)+(1.038)+(1.049), (I-746)+(1.038)+(1.050), (I-746)+(1.038)+(1.051), (I-746)+(1.038)+(1.052), (I-746)+(1.038)+(1.053), (I-746)+(1.038)+(1.054), (I-746)+(1.038)+(1.055), (I-746)+(1.038)+(1.056), (I-746)+(1.038)+(1.057), (I-746)+(1.038)+(1.058), (I-746)+(1.038)+(1.059), (I-746)+(1.038)+(1.060), (I-746)+(1.038)+(1.061), (I-746)+(1.038)+(1.062), (I-746)+(1.038)+(1.063), (I-746)+(1.038)+(1.064), (I-746)+(1.038)+(1.065), (I-746)+(1.038)+(1.066), (I-746)+(1.038)+(1.067), (I-746)+(1.038)+(1.068), (I-746)+(1.038)+(1.069), (I-746)+(1.038)+(1.070), (I-746)+(1.038)+(1.071), (I-746)+(1.038)+(1.072), (I-746)+(1.038)+(1.073), (I-746)+(1.038)+(1.074), (I-746)+(1.038)+(1.075), (I-746)+(1.038)+(1.076), (I-746)+(1.038)+(1.077), (I-746)+(1.038)+(1.078), (I-746)+(1.038)+(1.079), (I-746)+(1.038)+(1.080), (I-746)+(1.038)+(1.081), (I-746)+(1.038)+(1.082), (I-746)+(1.038)+(1.083), (I-746)+(1.038)+(1.084), (I-746)+(1.038)+(1.085), (I-746)+(1.038)+(1.086), (I-746)+(1.038)+(1.087), (I-746)+(1.038)+(1.088), (I-746)+(1.038)+(1.089), (I-746)+(1.038)+(1.090), (I-746)+(1.038)+(1.091), (I-746)+(1.038)+(1.092), (I-746)+(1.038)+(2.001), (I-746)+(1.038)+(2.002), (I-746)+(1.038)+(2.003), (I-746)+(1.038)+(2.004), (I-746)+(1.038)+(2.005), (I-746)+(1.038)+(2.006), (I-746)+(1.038)+(2.007), (I-746)+(1.038)+(2.008), (I-746)+(1.038)+(2.009), (I-746)+(1.038)+(2.010), (I-746)+(1.038)+(2.011), (I-746)+(1.038)+(2.012), (I-746)+(1.038)+(2.013), (I-746)+(1.038)+(2.014), (I-746)+(1.038)+(2.015), (I-746)+(1.038)+(2.016), (I-746)+(1.038)+(2.017), (I-746)+(1.038)+(2.018), (I-746)+(1.038)+(2.019), (I-746)+(1.038)+(2.020), (I-746)+(1.038)+(2.021), (I-746)+(1.038)+(2.022), (I-746)+(1.038)+(2.023), (I-746)+(1.038)+(2.024), (I-746)+(1.038)+(2.025), (I-746)+(1.038)+(2.026), (I-746)+(1.038)+(2.027), (I-746)+(1.038)+(2.028), (I-746)+(1.038)+(2.029), (I-746)+(1.038)+(2.030), (I-746)+(1.038)+(2.031), (I-746)+(1.038)+(2.032), (I-746)+(1.038)+(2.033), (I-746)+(1.038)+(2.034), (I-746)+(1.038)+(2.035), (I-746)+(1.038)+(2.036), (I-746)+(1.038)+(2.037), (I-746)+(1.038)+(2.038), (I-746)+(1.038)+(2.039), (I-746)+(1.038)+(2.040), (I-746)+(1.038)+(2.041), (I-746)+(1.038)+(2.042), (I-746)+(1.038)+(2.043), (I-746)+(1.038)+(2.044), (I-746)+(1.038)+(2.045), (I-746)+(1.038)+(2.046), (I-746)+(1.038)+(2.047), (I-746)+(1.038)+(2.048), (I-746)+(1.038)+(2.049), (I-746)+(1.038)+(2.050), (I-746)+(1.038)+(2.051), (I-746)+(1.038)+(2.052), (I-746)+(1.038)+(2.053), (I-746)+(1.038)+(2.054), (I-746)+(1.038)+(2.055), (I-746)+(1.038)+(2.056), (I-746)+(1.038)+(2.057), (I-746)+(1.038)+(2.058), (I-746)+(1.038)+(2.059), (I-746)+(1.038)+(3.001), (I-746)+(1.038)+(3.002), (I-746)+(1.038)+(3.003), (I-746)+(1.038)+(3.004), (I-746)+(1.038)+(3.005), (I-746)+(1.038)+(3.006), (I-746)+(1.038)+(3.007), (I-746)+(1.038)+(3.008), (I-746)+(1.038)+(3.009), (I-746)+(1.038)+(3.010), (I-746)+(1.038)+(3.011), (I-746)+(1.038)+(3.012), (I-746)+(1.038)+(3.013), (I-746)+(1.038)+(3.014), (I-746)+(1.038)+(3.015), (I-746)+(1.038)+(3.016), (I-746)+(1.038)+(3.017), (I-746)+(1.038)+(3.018), (I-746)+(1.038)+(3.019), (I-746)+(1.038)+(3.020), (I-746)+(1.038)+(3.021), (I-746)+(1.038)+(3.022), (I-746)+(1.038)+(3.023), (I-746)+(1.038)+(3.024), (I-746)+(1.038)+(3.025), (I-746)+(1.038)+(3.026), (I-746)+(1.038)+(3.027), (I-746)+(1.038)+(3.028), (I-746)+(1.038)+(3.029), (I-746)+(1.038)+(3.030), (I-746)+(1.038)+(3.031), (I-746)+(1.038)+(5.001), (I-746)+(1.038)+(5.002), (I-746)+(1.038)+(5.003), (I-746)+(1.038)+(5.004), (I-746)+(1.038)+(5.005), (I-746)+(1.038)+(5.006), (I-746)+(1.038)+(5.007), (I-746)+(1.038)+(5.008), (I-746)+(1.038)+(5.009), (I-746)+(1.038)+(5.010), (I-746)+(1.038)+(5.011), (I-746)+(1.038)+(5.012), (I-746)+(1.038)+(5.013), (I-746)+(1.038)+(5.014), (I-746)+(1.038)+(5.015), (I-746)+(1.038)+(5.016), (I-746)+(1.038)+(5.017), (I-746)+(1.038)+(5.018), (I-746)+(1.038)+(5.019), (I-746)+(1.038)+(5.020), (I-746)+(1.038)+(5.021), (I-746)+(1.038)+(5.022), (I-746)+(1.038)+(5.023), (I-746)+(1.038)+(6.001), (I-746)+(1.038)+(6.002), (I-746)+(1.038)+(6.003), (I-746)+(1.038)+(6.004), (I-746)+(1.038)+(7.001), (I-746)+(1.038)+(7.002), (I-746)+(1.038)+(7.003), (I-746)+(1.038)+(7.004), (I-746)+(1.038)+(7.005), (I-746)+(1.038)+(7.006), (I-746)+(1.038)+(9.001), (I-746)+(1.038)+(9.002), (I-746)+(1.038)+(9.003), (I-746)+(1.038)+(9.004), (I-746)+(1.038)+(9.005), (I-746)+(1.038)+(9.006), (I-746)+(1.038)+(9.007), (I-746)+(1.038)+(9.008), (I-746)+(1.038)+(9.009), (I-746)+(1.038)+(14.001), (I-746)+(1.038)+(14.002), (I-746)+(1.038)+(15.008), (I-746)+(1.038)+(15.011), (I-746)+(1.038)+(15.012), (I-746)+(1.038)+(15.016), (I-746)+(1.038)+(15.025), (I-746)+(1.038)+(15.027), (I-746)+(1.038)+(15.047), (I-746)+(1.038)+(15.063), (I-746)+(1.038)+(15.064), (I-746)+(1.038)+(16.001), (I-746)+(1.038)+(16.002), (I-746)+(1.038)+(16.003), (I-746)+(1.038)+(16.004), (I-746)+(1.038)+(16.005), (I-746)+(1.038)+(16.006), (I-746)+(1.038)+(16.007), (I-746)+(1.038)+(16.008), (I-746)+(1.038)+(17.001), (I-746)+(1.038)+(17.002), (I-746)+(1.038)+(17.003), (I-746)+(1.038)+(17.004), (I-746)+(1.038)+(17.005), (I-746)+(1.038)+(17.006), (I-746)+(1.038)+(17.007), (I-746)+(1.038)+(17.008), (I-746)+(1.038)+(17.009), (I-746)+(1.038)+(17.010), (I-746)+(1.038)+(17.011), (I-746)+(1.038)+(17.012), (I-746)+(1.038)+(18.001),

(I-746)+(1.039)+(1.040), (I-746)+(1.039)+(1.041), (I-746)+(1.039)+(1.042), (I-746)+(1.039)+(1.043), (I-746)+(1.039)+(1.044), (I-746)+(1.039)+(1.045), (I-746)+(1.039)+(1.046), (I-746)+(1.039)+(1.047), (I-746)+(1.039)+(1.048), (I-746)+(1.039)+(1.049), (I-746)+(1.039)+(1.050), (I-746)+(1.039)+(1.051), (I-746)+(1.039)+(1.052), (I-746)+(1.039)+(1.053), (I-746)+(1.039)+(1.054), (I-746)+(1.039)+(1.055), (I-746)+(1.039)+(1.056), (I-746)+(1.039)+(1.057), (I-746)+(1.039)+(1.058), (I-746)+(1.039)+(1.059), (I-746)+(1.039)+(1.060), (I-746)+(1.039)+(1.061), (I-746)+(1.039)+(1.062), (I-746)+(1.039)+(1.063), (I-746)+(1.039)+(1.064), (I-746)+(1.039)+(1.065), (I-746)+(1.039)+(1.066), (I-746)+(1.039)+(1.067), (I-746)+(1.039)+(1.068), (I-746)+(1.039)+(1.069), (I-746)+(1.039)+(1.070), (I-746)+(1.039)+(1.071), (I-746)+(1.039)+(1.072), (I-746)+(1.039)+(1.073), (I-746)+(1.039)+(1.074), (I-746)+(1.039)+(1.075), (I-746)+(1.039)+(1.076), (I-746)+(1.039)+(1.077), (I-746)+(1.039)+(1.078), (I-746)+(1.039)+(1.079), (I-746)+(1.039)+(1.080), (I-746)+(1.039)+(1.081), (I-746)+(1.039)+(1.082), (I-746)+(1.039)+(1.083), (I-746)+(1.039)+(1.084), (I-746)+(1.039)+(1.085), (I-746)+(1.039)+(1.086), (I-746)+(1.039)+(1.087), (I-746)+(1.039)+(1.088), (I-746)+(1.039)+(1.089), (I-746)+(1.039)+(1.090), (I-746)+(1.039)+(1.091), (I-746)+(1.039)+(1.092), (I-746)+(1.039)+(2.001), (I-746)+(1.039)+(2.002), (I-746)+(1.039)+(2.003), (I-746)+(1.039)+(2.004), (I-746)+(1.039)+(2.005), (I-746)+(1.039)+(2.006), (I-746)+(1.039)+(2.007), (I-746)+(1.039)+(2.008), (I-746)+(1.039)+(2.009), (I-746)+(1.039)+(2.010), (I-746)+(1.039)+(2.011), (I-746)+(1.039)+(2.012), (I-746)+(1.039)+(2.013), (I-746)+(1.039)+(2.014), (I-746)+(1.039)+(2.015), (I-746)+(1.039)+(2.016), (I-746)+(1.039)+(2.017), (I-746)+(1.039)+(2.018), (I-746)+(1.039)+(2.019), (I-746)+(1.039)+(2.020), (I-746)+(1.039)+(2.021), (I-746)+(1.039)+(2.022), (I-746)+(1.039)+(2.023), (I-746)+(1.039)+(2.024), (I-746)+(1.039)+(2.025), (I-746)+(1.039)+(2.026), (I-746)+(1.039)+(2.027), (I-746)+(1.039)+(2.028), (I-746)+(1.039)+(2.029), (I-746)+(1.039)+(2.030), (I-746)+(1.039)+(2.031), (I-746)+(1.039)+(2.032), (I-746)+(1.039)+(2.033), (I-746)+(1.039)+(2.034), (I-746)+(1.039)+(2.035), (I-746)+(1.039)+(2.036), (I-746)+(1.039)+(2.037), (I-746)+(1.039)+(2.038), (I-746)+(1.039)+(2.039), (I-746)+(1.039)+(2.040), (I-746)+(1.039)+(2.041), (I-746)+(1.039)+(2.042), (I-746)+(1.039)+(2.043), (I-746)+(1.039)+(2.044), (I-746)+(1.039)+(2.045), (I-746)+(1.039)+(2.046), (I-746)+(1.039)+(2.047), (I-746)+(1.039)+(2.048), (I-746)+(1.039)+(2.049), (I-746)+(1.039)+(2.050), (I-746)+(1.039)+(2.051), (I-746)+(1.039)+(2.052), (I-746)+(1.039)+(2.053), (I-746)+(1.039)+(2.054), (I-746)+(1.039)+(2.055), (I-746)+(1.039)+(2.056), (I-746)+(1.039)+(2.057), (I-746)+(1.039)+(2.058), (I-746)+(1.039)+(2.059), (I-746)+(1.039)+(3.001), (I-746)+(1.039)+(3.002), (I-746)+(1.039)+(3.003), (I-746)+(1.039)+(3.004), (I-746)+(1.039)+(3.005), (I-746)+(1.039)+(3.006), (I-746)+(1.039)+(3.007), (I-746)+(1.039)+(3.008), (I-746)+(1.039)+(3.009), (I-746)+(1.039)+(3.010), (I-746)+(1.039)+(3.011), (I-746)+(1.039)+(3.012), (I-746)+(1.039)+(3.013), (I-746)+(1.039)+(3.014), (I-746)+(1.039)+(3.015), (I-746)+(1.039)+(3.016), (I-746)+(1.039)+(3.017), (I-746)+(1.039)+(3.018), (I-746)+(1.039)+(3.019), (I-746)+(1.039)+(3.020), (I-746)+(1.039)+(3.021), (I-746)+(1.039)+(3.022), (I-746)+(1.039)+(3.023), (I-746)+(1.039)+(3.024), (I-746)+(1.039)+(3.025), (I-746)+(1.039)+(3.026), (I-746)+(1.039)+(3.027), (I-746)+(1.039)+(3.028), (I-746)+(1.039)+(3.029), (I-746)+(1.039)+(3.030), (I-746)+(1.039)+(3.031), (I-746)+(1.039)+(5.001), (I-746)+(1.039)+(5.002), (I-746)+(1.039)+(5.003), (I-746)+(1.039)+(5.004), (I-746)+(1.039)+(5.005), (I-746)+(1.039)+(5.006), (I-746)+(1.039)+(5.007), (I-746)+(1.039)+(5.008), (I-746)+(1.039)+(5.009), (I-746)+(1.039)+(5.010), (I-746)+(1.039)+(5.011), (I-746)+(1.039)+(5.012), (I-746)+(1.039)+(5.013), (I-746)+(1.039)+(5.014), (I-746)+(1.039)+(5.015), (I-746)+(1.039)+(5.016), (I-746)+(1.039)+(5.017), (I-746)+(1.039)+(5.018), (I-746)+(1.039)+(5.019), (I-746)+(1.039)+(5.020), (I-746)+(1.039)+(5.021), (I-746)+(1.039)+(5.022), (I-746)+(1.039)+(5.023), (I-746)+(1.039)+(6.001), (I-746)+(1.039)+(6.002), (I-746)+(1.039)+(6.003), (I-746)+(1.039)+(6.004), (I-746)+(1.039)+(7.001), (I-746)+(1.039)+(7.002), (I-746)+(1.039)+(7.003), (I-746)+(1.039)+(7.004), (I-746)+(1.039)+(7.005), (I-746)+(1.039)+(7.006), (I-746)+(1.039)+(9.001), (I-746)+(1.039)+(9.002), (I-746)+(1.039)+(9.003), (I-746)+(1.039)+(9.004), (I-746)+(1.039)+(9.005), (I-746)+(1.039)+(9.006), (I-746)+(1.039)+(9.007), (I-746)+(1.039)+(9.008), (I-746)+(1.039)+(9.009), (I-746)+(1.039)+(14.001), (I-746)+(1.039)+(14.002), (I-746)+(1.039)+(15.008), (I-746)+(1.039)+(15.011), (I-746)+(1.039)+(15.012), (I-746)+(1.039)+(15.016), (I-746)+(1.039)+(15.025), (I-746)+(1.039)+(15.027), (I-746)+(1.039)+(15.047), (I-746)+(1.039)+(15.063), (I-746)+(1.039)+(15.064), (I-746)+(1.039)+(16.001), (I-746)+(1.039)+(16.002), (I-746)+(1.039)+(16.003), (I-746)+(1.039)+(16.004), (I-746)+(1.039)+(16.005), (I-746)+(1.039)+(16.006), (I-746)+(1.039)+(16.007), (I-746)+(1.039)+(16.008), (I-746)+(1.039)+(17.001), (I-746)+(1.039)+(17.002), (I-746)+(1.039)+(17.003), (I-746)+(1.039)+(17.004), (I-746)+(1.039)+(17.005), (I-746)+(1.039)+(17.006), (I-746)+(1.039)+(17.007), (I-746)+(1.039)+(17.008), (I-746)+(1.039)+(17.009), (I-746)+(1.039)+(17.010), (I-746)+(1.039)+(17.011), (I-746)+(1.039)+(17.012), (I-746)+(1.039)+(18.001),

(I-746)+(1.040)+(1.041), (I-746)+(1.040)+(1.042), (I-746)+(1.040)+(1.043), (I-746)+(1.040)+(1.044), (I-746)+(1.040)+(1.045), (I-746)+(1.040)+(1.046), (I-746)+(1.040)+(1.047), (I-746)+(1.040)+(1.048), (I-746)+(1.040)+(1.049), (I-746)+(1.040)+(1.050), (I-746)+(1.040)+(1.051), (I-746)+(1.040)+(1.052), (I-746)+(1.040)+(1.053), (I-746)+(1.040)+(1.054), (I-746)+(1.040)+(1.055), (I-746)+(1.040)+(1.056), (I-746)+(1.040)+(1.057), (I-746)+(1.040)+(1.058), (I-746)+(1.040)+(1.059), (I-746)+(1.040)+(1.060), (I-746)+(1.040)+(1.061), (I-746)+(1.040)+(1.062), (I-746)+(1.040)+(1.063), (I-746)+(1.040)+(1.064), (I-746)+(1.040)+(1.065), (I-746)+(1.040)+(1.066), (I-746)+(1.040)+(1.067), (I-746)+(1.040)+(1.068), (I-746)+(1.040)+(1.069), (I-746)+(1.040)+(1.070), (I-746)+(1.040)+(1.071), (I-746)+(1.040)+(1.072), (I-746)+(1.040)+(1.073), (I-746)+(1.040)+(1.074), (I-746)+(1.040)+(1.075), (I-746)+(1.040)+(1.076), (I-746)+(1.040)+(1.077), (I-746)+(1.040)+(1.078), (I-746)+(1.040)+(1.079), (I-746)+(1.040)+(1.080), (I-746)+(1.040)+(1.081), (I-746)+(1.040)+(1.082), (I-746)+(1.040)+(1.083), (I-746)+(1.040)+(1.084), (I-746)+(1.040)+(1.085), (I-746)+(1.040)+(1.086), (I-746)+(1.040)+(1.087), (I-746)+(1.040)+(1.088), (I-746)+(1.040)+(1.089), (I-746)+(1.040)+(1.090), (I-746)+(1.040)+(1.091), (I-746)+(1.040)+(1.092), (I-746)+(1.040)+(2.001), (I-746)+(1.040)+(2.002), (I-746)+(1.040)+(2.003), (I-746)+(1.040)+(2.004), (I-746)+(1.040)+(2.005), (I-746)+(1.040)+(2.006), (I-746)+(1.040)+(2.007), (I-746)+(1.040)+(2.008), (I-746)+(1.040)+(2.009), (I-746)+(1.040)+(2.010), (I-746)+(1.040)+(2.011), (I-746)+(1.040)+(2.012), (I-746)+(1.040)+(2.013), (I-746)+(1.040)+(2.014), (I-746)+(1.040)+(2.015), (I-746)+(1.040)+(2.016), (I-746)+(1.040)+(2.017), (I-746)+(1.040)+(2.018), (I-746)+(1.040)+(2.019), (I-746)+(1.040)+(2.020), (I-746)+(1.040)+(2.021), (I-746)+(1.040)+(2.022), (I-746)+(1.040)+(2.023), (I-746)+(1.040)+(2.024), (I-746)+(1.040)+(2.025), (I-746)+(1.040)+(2.026), (I-746)+(1.040)+(2.027), (I-746)+(1.040)+(2.028), (I-746)+(1.040)+(2.029), (I-746)+(1.040)+(2.030), (I-746)+(1.040)+(2.031), (I-746)+(1.040)+(2.032), (I-746)+(1.040)+(2.033), (I-746)+(1.040)+(2.034), (I-746)+(1.040)+(2.035), (I-746)+(1.040)+(2.036), (I-746)+(1.040)+(2.037), (I-746)+(1.040)+(2.038), (I-746)+(1.040)+(2.039), (I-746)+(1.040)+(2.040), (I-746)+(1.040)+(2.041), (I-746)+(1.040)+(2.042), (I-746)+(1.040)+(2.043), (I-746)+(1.040)+(2.044), (I-746)+(1.040)+(2.045), (I-746)+(1.040)+(2.046), (I-746)+(1.040)+(2.047), (I-746)+(1.040)+(2.048), (I-746)+(1.040)+(2.049), (I-746)+(1.040)+(2.050), (I-746)+(1.040)+(2.051), (I-746)+(1.040)+(2.052), (I-746)+(1.040)+(2.053), (I-746)+(1.040)+(2.054), (I-746)+(1.040)+(2.055), (I-746)+(1.040)+(2.056), (I-746)+(1.040)+(2.057), (I-746)+(1.040)+(2.058), (I-746)+(1.040)+(2.059), (I-746)+(1.040)+(3.001), (I-746)+(1.040)+(3.002), (I-746)+(1.040)+(3.003), (I-746)+(1.040)+(3.004), (I-746)+(1.040)+(3.005), (I-746)+(1.040)+(3.006), (I-746)+(1.040)+(3.007), (I-746)+(1.040)+(3.008), (I-746)+(1.040)+(3.009), (I-746)+(1.040)+(3.010), (I-746)+(1.040)+(3.011), (I-746)+(1.040)+(3.012), (I-746)+(1.040)+(3.013), (I-746)+(1.040)+(3.014), (I-746)+(1.040)+(3.015), (I-746)+(1.040)+(3.016), (I-746)+(1.040)+(3.017), (I-746)+(1.040)+(3.018), (I-746)+(1.040)+(3.019), (I-746)+(1.040)+(3.020), (I-746)+(1.040)+(3.021), (I-746)+(1.040)+(3.022), (I-746)+(1.040)+(3.023), (I-746)+(1.040)+(3.024), (I-746)+(1.040)+(3.025), (I-746)+(1.040)+(3.026), (I-746)+(1.040)+(3.027), (I-746)+(1.040)+(3.028), (I-746)+(1.040)+(3.029), (I-746)+(1.040)+(3.030), (I-746)+(1.040)+(3.031), (I-746)+(1.040)+(5.001), (I-746)+(1.040)+(5.002), (I-746)+(1.040)+(5.003), (I-746)+(1.040)+(5.004), (I-746)+(1.040)+(5.005), (I-746)+(1.040)+(5.006), (I-746)+(1.040)+(5.007), (I-746)+(1.040)+(5.008), (I-746)+(1.040)+(5.009), (I-746)+(1.040)+(5.010), (I-746)+(1.040)+(5.011), (I-746)+(1.040)+(5.012), (I-746)+(1.040)+(5.013), (I-746)+(1.040)+(5.014), (I-746)+(1.040)+(5.015), (I-746)+(1.040)+(5.016), (I-746)+(1.040)+(5.017), (I-746)+(1.040)+(5.018), (I-746)+(1.040)+(5.019), (I-746)+(1.040)+(5.020), (I-746)+(1.040)+(5.021), (I-746)+(1.040)+(5.022), (I-746)+(1.040)+(5.023), (I-746)+(1.040)+(6.001), (I-746)+(1.040)+(6.002), (I-746)+(1.040)+(6.003), (I-746)+(1.040)+(6.004), (I-746)+(1.040)+(7.001), (I-746)+(1.040)+(7.002), (I-746)+(1.040)+(7.003), (I-746)+(1.040)+(7.004), (I-746)+(1.040)+(7.005), (I-746)+(1.040)+(7.006), (I-746)+(1.040)+(9.001), (I-746)+(1.040)+(9.002), (I-746)+(1.040)+(9.003), (I-746)+(1.040)+(9.004), (I-746)+(1.040)+(9.005), (I-746)+(1.040)+(9.006), (I-746)+(1.040)+(9.007), (I-746)+(1.040)+(9.008), (I-746)+(1.040)+(9.009), (I-746)+(1.040)+(14.001), (I-746)+(1.040)+(14.002), (I-746)+(1.040)+(15.008), (I-746)+(1.040)+(15.011), (I-746)+(1.040)+(15.012), (I-746)+(1.040)+(15.016), (I-746)+(1.040)+(15.025), (I-746)+(1.040)+(15.027), (I-746)+(1.040)+(15.047), (I-746)+(1.040)+(15.063), (I-746)+(1.040)+(15.064), (I-746)+(1.040)+(16.001), (I-746)+(1.040)+(16.002), (I-746)+(1.040)+(16.003), (I-746)+(1.040)+(16.004), (I-746)+(1.040)+(16.005), (I-746)+(1.040)+(16.006), (I-746)+(1.040)+(16.007), (I-746)+(1.040)+(16.008), (I-746)+(1.040)+(17.001), (I-746)+(1.040)+(17.002), (I-746)+(1.040)+(17.003), (I-746)+(1.040)+(17.004), (I-746)+(1.040)+(17.005), (I-746)+(1.040)+(17.006), (I-746)+(1.040)+(17.007), (I-746)+(1.040)+(17.008), (I-746)+(1.040)+(17.009), (I-746)+(1.040)+(17.010), (I-746)+(1.040)+(17.011), (I-746)+(1.040)+(17.012), (I-746)+(1.040)+(18.001),

(I-746)+(1.041)+(1.042), (I-746)+(1.041)+(1.043), (I-746)+(1.041)+(1.044), (I-746)+(1.041)+(1.045), (I-746)+(1.041)+(1.046), (I-746)+(1.041)+(1.047), (I-746)+(1.041)+(1.048), (I-746)+(1.041)+(1.049), (I-746)+(1.041)+(1.050), (I-746)+(1.041)+(1.051), (I-746)+(1.041)+(1.052), (I-746)+(1.041)+(1.053), (I-746)+(1.041)+(1.054), (I-746)+(1.041)+(1.055), (I-746)+(1.041)+(1.056), (I-746)+(1.041)+(1.057), (I-746)+(1.041)+(1.058), (I-746)+(1.041)+(1.059), (I-746)+(1.041)+(1.060), (I-746)+(1.041)+(1.061), (I-746)+(1.041)+(1.062), (I-746)+(1.041)+(1.063), (I-746)+(1.041)+(1.064), (I-746)+(1.041)+(1.065), (I-746)+(1.041)+(1.066), (I-746)+(1.041)+(1.067), (I-746)+(1.041)+(1.068), (I-746)+(1.041)+(1.069), (I-746)+(1.041)+(1.070), (I-746)+(1.041)+(1.071), (I-746)+(1.041)+(1.072), (I-746)+(1.041)+(1.073), (I-746)+(1.041)+(1.074), (I-746)+(1.041)+(1.075), (I-746)+(1.041)+(1.076), (I-746)+(1.041)+(1.077), (I-746)+(1.041)+(1.078), (I-746)+(1.041)+(1.079), (I-746)+(1.041)+(1.080), (I-746)+(1.041)+(1.081), (I-746)+(1.041)+(1.082), (I-746)+(1.041)+(1.083), (I-746)+(1.041)+(1.084), (I-746)+(1.041)+(1.085), (I-746)+(1.041)+(1.086), (I-746)+(1.041)+(1.087), (I-746)+(1.041)+(1.088), (I-746)+(1.041)+(1.089), (I-746)+(1.041)+(1.090), (I-746)+(1.041)+(1.091), (I-746)+(1.041)+(1.092), (I-746)+(1.041)+(2.001), (I-746)+(1.041)+(2.002), (I-746)+(1.041)+(2.003), (I-746)+(1.041)+(2.004), (I-746)+(1.041)+(2.005), (I-746)+(1.041)+(2.006), (I-746)+(1.041)+(2.007), (I-746)+(1.041)+(2.008), (I-746)+(1.041)+(2.009), (I-746)+(1.041)+(2.010), (I-746)+(1.041)+(2.011), (I-746)+(1.041)+(2.012), (I-746)+(1.041)+(2.013), (I-746)+(1.041)+(2.014), (I-746)+(1.041)+(2.015), (I-746)+(1.041)+(2.016), (I-746)+(1.041)+(2.017), (I-746)+(1.041)+(2.018), (I-746)+(1.041)+(2.019), (I-746)+(1.041)+(2.020), (I-746)+(1.041)+(2.021), (I-746)+(1.041)+(2.022), (I-746)+(1.041)+(2.023), (I-746)+(1.041)+(2.024), (I-746)+(1.041)+(2.025), (I-746)+(1.041)+(2.026), (I-746)+(1.041)+(2.027), (I-746)+(1.041)+(2.028), (I-746)+(1.041)+(2.029), (I-746)+(1.041)+(2.030), (I-746)+(1.041)+(2.031), (I-746)+(1.041)+(2.032), (I-746)+(1.041)+(2.033), (I-746)+(1.041)+(2.034), (I-746)+(1.041)+(2.035), (I-746)+(1.041)+(2.036), (I-746)+(1.041)+(2.037), (I-746)+(1.041)+(2.038), (I-746)+(1.041)+(2.039), (I-746)+(1.041)+(2.040), (I-746)+(1.041)+(2.041), (I-746)+(1.041)+(2.042), (I-746)+(1.041)+(2.043), (I-746)+(1.041)+(2.044), (I-746)+(1.041)+(2.045), (I-746)+(1.041)+(2.046), (I-746)+(1.041)+(2.047), (I-746)+(1.041)+(2.048), (I-746)+(1.041)+(2.049), (I-746)+(1.041)+(2.050), (I-746)+(1.041)+(2.051), (I-746)+(1.041)+(2.052), (I-746)+(1.041)+(2.053), (I-746)+(1.041)+(2.054), (I-746)+(1.041)+(2.055), (I-746)+(1.041)+(2.056), (I-746)+(1.041)+(2.057), (I-746)+(1.041)+(2.058), (I-746)+(1.041)+(2.059), (I-746)+(1.041)+(3.001), (I-746)+(1.041)+(3.002), (I-746)+(1.041)+(3.003), (I-746)+(1.041)+(3.004), (I-746)+(1.041)+(3.005), (I-746)+(1.041)+(3.006), (I-746)+(1.041)+(3.007), (I-746)+(1.041)+(3.008), (I-746)+(1.041)+(3.009), (I-746)+(1.041)+(3.010), (I-746)+(1.041)+(3.011), (I-746)+(1.041)+(3.012), (I-746)+(1.041)+(3.013), (I-746)+(1.041)+(3.014), (I-746)+(1.041)+(3.015), (I-746)+(1.041)+(3.016), (I-746)+(1.041)+(3.017), (I-746)+(1.041)+(3.018), (I-746)+(1.041)+(3.019), (I-746)+(1.041)+(3.020), (I-746)+(1.041)+(3.021), (I-746)+(1.041)+(3.022), (I-746)+(1.041)+(3.023), (I-746)+(1.041)+(3.024), (I-746)+(1.041)+(3.025), (I-746)+(1.041)+(3.026), (I-746)+(1.041)+(3.027), (I-746)+(1.041)+(3.028), (I-746)+(1.041)+(3.029), (I-746)+(1.041)+(3.030), (I-746)+(1.041)+(3.031), (I-746)+(1.041)+(5.001), (I-746)+(1.041)+(5.002), (I-746)+(1.041)+(5.003), (I-746)+(1.041)+(5.004), (I-746)+(1.041)+(5.005), (I-746)+(1.041)+(5.006), (I-746)+(1.041)+(5.007), (I-746)+(1.041)+(5.008), (I-746)+(1.041)+(5.009), (I-746)+(1.041)+(5.010), (I-746)+(1.041)+(5.011), (I-746)+(1.041)+(5.012), (I-746)+(1.041)+(5.013), (I-746)+(1.041)+(5.014), (I-746)+(1.041)+(5.015), (I-746)+(1.041)+(5.016), (I-746)+(1.041)+(5.017), (I-746)+(1.041)+(5.018), (I-746)+(1.041)+(5.019), (I-746)+(1.041)+(5.020), (I-746)+(1.041)+(5.021), (I-746)+(1.041)+(5.022), (I-746)+(1.041)+(5.023), (I-746)+(1.041)+(6.001), (I-746)+(1.041)+(6.002), (I-746)+(1.041)+(6.003), (I-746)+(1.041)+(6.004), (I-746)+(1.041)+(7.001), (I-746)+(1.041)+(7.002), (I-746)+(1.041)+(7.003), (I-746)+(1.041)+(7.004), (I-746)+(1.041)+(7.005), (I-746)+(1.041)+(7.006), (I-746)+(1.041)+(9.001), (I-746)+(1.041)+(9.002), (I-746)+(1.041)+(9.003), (I-746)+(1.041)+(9.004), (I-746)+(1.041)+(9.005), (I-746)+(1.041)+(9.006), (I-746)+(1.041)+(9.007), (I-746)+(1.041)+(9.008), (I-746)+(1.041)+(9.009), (I-746)+(1.041)+(14.001), (I-746)+(1.041)+(14.002), (I-746)+(1.041)+(15.008), (I-746)+(1.041)+(15.011), (I-746)+(1.041)+(15.012), (I-746)+(1.041)+(15.016), (I-746)+(1.041)+(15.025), (I-746)+(1.041)+(15.027), (I-746)+(1.041)+(15.047), (I-746)+(1.041)+(15.063), (I-746)+(1.041)+(15.064), (I-746)+(1.041)+(16.001), (I-746)+(1.041)+(16.002), (I-746)+(1.041)+(16.003), (I-746)+(1.041)+(16.004), (I-746)+(1.041)+(16.005), (I-746)+(1.041)+(16.006), (I-746)+(1.041)+(16.007), (I-746)+(1.041)+(16.008), (I-746)+(1.041)+(17.001), (I-746)+(1.041)+(17.002), (I-746)+(1.041)+(17.003), (I-746)+(1.041)+(17.004), (I-746)+(1.041)+(17.005), (I-746)+(1.041)+(17.006), (I-746)+(1.041)+(17.007), (I-746)+(1.041)+(17.008), (I-746)+(1.041)+(17.009), (I-746)+(1.041)+(17.010), (I-746)+(1.041)+(17.011), (I-746)+(1.041)+(17.012), (I-746)+(1.041)+(18.001),

(I-746)+(1.042)+(1.043), (I-746)+(1.042)+(1.044), (I-746)+(1.042)+(1.045), (I-746)+(1.042)+(1.046), (I-746)+(1.042)+(1.047), (I-746)+(1.042)+(1.048), (I-746)+(1.042)+(1.049), (I-746)+(1.042)+(1.050), (I-746)+(1.042)+(1.051), (I-746)+(1.042)+(1.052), (I-746)+(1.042)+(1.053), (I-746)+(1.042)+(1.054), (I-746)+(1.042)+(1.055), (I-746)+(1.042)+(1.056), (I-746)+(1.042)+(1.057), (I-746)+(1.042)+(1.058), (I-746)+(1.042)+(1.059), (I-746)+(1.042)+(1.060), (I-746)+(1.042)+(1.061), (I-746)+(1.042)+(1.062), (I-746)+(1.042)+(1.063), (I-746)+(1.042)+(1.064), (I-746)+(1.042)+(1.065), (I-746)+(1.042)+(1.066), (I-746)+(1.042)+(1.067), (I-746)+(1.042)+(1.068), (I-746)+(1.042)+(1.069), (I-746)+(1.042)+(1.070), (I-746)+(1.042)+(1.071), (I-746)+(1.042)+(1.072), (I-746)+(1.042)+(1.073), (I-746)+(1.042)+(1.074), (I-746)+(1.042)+(1.075), (I-746)+(1.042)+(1.076), (I-746)+(1.042)+(1.077), (I-746)+(1.042)+(1.078), (I-746)+(1.042)+(1.079), (I-746)+(1.042)+(1.080), (I-746)+(1.042)+(1.081), (I-746)+(1.042)+(1.082), (I-746)+(1.042)+(1.083), (I-746)+(1.042)+(1.084), (I-746)+(1.042)+(1.085), (I-746)+(1.042)+(1.086), (I-746)+(1.042)+(1.087), (I-746)+(1.042)+(1.088), (I-746)+(1.042)+(1.089), (I-746)+(1.042)+(1.090), (I-746)+(1.042)+(1.091), (I-746)+(1.042)+(1.092), (I-746)+(1.042)+(2.001), (I-746)+(1.042)+(2.002), (I-746)+(1.042)+(2.003), (I-746)+(1.042)+(2.004), (I-746)+(1.042)+(2.005), (I-746)+(1.042)+(2.006), (I-746)+(1.042)+(2.007), (I-746)+(1.042)+(2.008), (I-746)+(1.042)+(2.009), (I-746)+(1.042)+(2.010), (I-746)+(1.042)+(2.011), (I-746)+(1.042)+(2.012), (I-746)+(1.042)+(2.013), (I-746)+(1.042)+(2.014), (I-746)+(1.042)+(2.015), (I-746)+(1.042)+(2.016), (I-746)+(1.042)+(2.017), (I-746)+(1.042)+(2.018), (I-746)+(1.042)+(2.019), (I-746)+(1.042)+(2.020), (I-746)+(1.042)+(2.021), (I-746)+(1.042)+(2.022), (I-746)+(1.042)+(2.023), (I-746)+(1.042)+(2.024), (I-746)+(1.042)+(2.025), (I-746)+(1.042)+(2.026), (I-746)+(1.042)+(2.027), (I-746)+(1.042)+(2.028), (I-746)+(1.042)+(2.029), (I-746)+(1.042)+(2.030), (I-746)+(1.042)+(2.031), (I-746)+(1.042)+(2.032), (I-746)+(1.042)+(2.033), (I-746)+(1.042)+(2.034), (I-746)+(1.042)+(2.035), (I-746)+(1.042)+(2.036), (I-746)+(1.042)+(2.037), (I-746)+(1.042)+(2.038), (I-746)+(1.042)+(2.039), (I-746)+(1.042)+(2.040), (I-746)+(1.042)+(2.041), (I-746)+(1.042)+(2.042), (I-746)+(1.042)+(2.043), (I-746)+(1.042)+(2.044), (I-746)+(1.042)+(2.045), (I-746)+(1.042)+(2.046), (I-746)+(1.042)+(2.047), (I-746)+(1.042)+(2.048), (I-746)+(1.042)+(2.049), (I-746)+(1.042)+(2.050), (I-746)+(1.042)+(2.051), (I-746)+(1.042)+(2.052), (I-746)+(1.042)+(2.053), (I-746)+(1.042)+(2.054), (I-746)+(1.042)+(2.055), (I-746)+(1.042)+(2.056), (I-746)+(1.042)+(2.057), (I-746)+(1.042)+(2.058), (I-746)+(1.042)+(2.059), (I-746)+(1.042)+(3.001), (I-746)+(1.042)+(3.002), (I-746)+(1.042)+(3.003), (I-746)+(1.042)+(3.004), (I-746)+(1.042)+(3.005), (I-746)+(1.042)+(3.006), (I-746)+(1.042)+(3.007), (I-746)+(1.042)+(3.008), (I-746)+(1.042)+(3.009), (I-746)+(1.042)+(3.010), (I-746)+(1.042)+(3.011), (I-746)+(1.042)+(3.012), (I-746)+(1.042)+(3.013), (I-746)+(1.042)+(3.014), (I-746)+(1.042)+(3.015), (I-746)+(1.042)+(3.016), (I-746)+(1.042)+(3.017), (I-746)+(1.042)+(3.018), (I-746)+(1.042)+(3.019), (I-746)+(1.042)+(3.020), (I-746)+(1.042)+(3.021), (I-746)+(1.042)+(3.022), (I-746)+(1.042)+(3.023), (I-746)+(1.042)+(3.024), (I-746)+(1.042)+(3.025), (I-746)+(1.042)+(3.026), (I-746)+(1.042)+(3.027), (I-746)+(1.042)+(3.028), (I-746)+(1.042)+(3.029), (I-746)+(1.042)+(3.030), (I-746)+(1.042)+(3.031), (I-746)+(1.042)+(5.001), (I-746)+(1.042)+(5.002), (I-746)+(1.042)+(5.003), (I-746)+(1.042)+(5.004), (I-746)+(1.042)+(5.005), (I-746)+(1.042)+(5.006), (I-746)+(1.042)+(5.007), (I-746)+(1.042)+(5.008), (I-746)+(1.042)+(5.009), (I-746)+(1.042)+(5.010), (I-746)+(1.042)+(5.011), (I-746)+(1.042)+(5.012), (I-746)+(1.042)+(5.013), (I-746)+(1.042)+(5.014), (I-746)+(1.042)+(5.015), (I-746)+(1.042)+(5.016), (I-746)+(1.042)+(5.017), (I-746)+(1.042)+(5.018), (I-746)+(1.042)+(5.019), (I-746)+(1.042)+(5.020), (I-746)+(1.042)+(5.021), (I-746)+(1.042)+(5.022), (I-746)+(1.042)+(5.023), (I-746)+(1.042)+(6.001), (I-746)+(1.042)+(6.002), (I-746)+(1.042)+(6.003), (I-746)+(1.042)+(6.004), (I-746)+(1.042)+(7.001), (I-746)+(1.042)+(7.002), (I-746)+(1.042)+(7.003), (I-746)+(1.042)+(7.004), (I-746)+(1.042)+(7.005), (I-746)+(1.042)+(7.006), (I-746)+(1.042)+(9.001), (I-746)+(1.042)+(9.002), (I-746)+(1.042)+(9.003), (I-746)+(1.042)+(9.004), (I-746)+(1.042)+(9.005), (I-746)+(1.042)+(9.006), (I-746)+(1.042)+(9.007), (I-746)+(1.042)+(9.008), (I-746)+(1.042)+(9.009), (I-746)+(1.042)+(14.001), (I-746)+(1.042)+(14.002), (I-746)+(1.042)+(15.008), (I-746)+(1.042)+(15.011), (I-746)+(1.042)+(15.012), (I-746)+(1.042)+(15.016), (I-746)+(1.042)+(15.025), (I-746)+(1.042)+(15.027), (I-746)+(1.042)+(15.047), (I-746)+(1.042)+(15.063), (I-746)+(1.042)+(15.064), (I-746)+(1.042)+(16.001), (I-746)+(1.042)+(16.002), (I-746)+(1.042)+(16.003), (I-746)+(1.042)+(16.004), (I-746)+(1.042)+(16.005), (I-746)+(1.042)+(16.006), (I-746)+(1.042)+(16.007), (I-746)+(1.042)+(16.008), (I-746)+(1.042)+(17.001), (I-746)+(1.042)+(17.002), (I-746)+(1.042)+(17.003), (I-746)+(1.042)+(17.004), (I-746)+(1.042)+(17.005), (I-746)+(1.042)+(17.006), (I-746)+(1.042)+(17.007), (I-746)+(1.042)+(17.008), (I-746)+(1.042)+(17.009), (I-746)+(1.042)+(17.010), (I-746)+(1.042)+(17.011), (I-746)+(1.042)+(17.012), (I-746)+(1.042)+(18.001),

(I-746)+(1.043)+(1.044), (I-746)+(1.043)+(1.045), (I-746)+(1.043)+(1.046), (I-746)+(1.043)+(1.047), (I-746)+(1.043)+(1.048), (I-746)+(1.043)+(1.049), (I-746)+(1.043)+(1.050), (I-746)+(1.043)+(1.051), (I-746)+(1.043)+(1.052), (I-746)+(1.043)+(1.053), (I-746)+(1.043)+(1.054), (I-746)+(1.043)+(1.055), (I-746)+(1.043)+(1.056), (I-746)+(1.043)+(1.057), (I-746)+(1.043)+(1.058), (I-746)+(1.043)+(1.059), (I-746)+(1.043)+(1.060), (I-746)+(1.043)+(1.061), (I-746)+(1.043)+(1.062), (I-746)+(1.043)+(1.063), (I-746)+(1.043)+(1.064), (I-746)+(1.043)+(1.065), (I-746)+(1.043)+(1.066), (I-746)+(1.043)+(1.067), (I-746)+(1.043)+(1.068), (I-746)+(1.043)+(1.069), (I-746)+(1.043)+(1.070), (I-746)+(1.043)+(1.071), (I-746)+(1.043)+(1.072), (I-746)+(1.043)+(1.073), (I-746)+(1.043)+(1.074), (I-746)+(1.043)+(1.075), (I-746)+(1.043)+(1.076), (I-746)+(1.043)+(1.077), (I-746)+(1.043)+(1.078), (I-746)+(1.043)+(1.079), (I-746)+(1.043)+(1.080), (I-746)+(1.043)+(1.081), (I-746)+(1.043)+(1.082), (I-746)+(1.043)+(1.083), (I-746)+(1.043)+(1.084), (I-746)+(1.043)+(1.085), (I-746)+(1.043)+(1.086), (I-746)+(1.043)+(1.087), (I-746)+(1.043)+(1.088), (I-746)+(1.043)+(1.089), (I-746)+(1.043)+(1.090), (I-746)+(1.043)+(1.091), (I-746)+(1.043)+(1.092), (I-746)+(1.043)+(2.001), (I-746)+(1.043)+(2.002), (I-746)+(1.043)+(2.003), (I-746)+(1.043)+(2.004), (I-746)+(1.043)+(2.005), (I-746)+(1.043)+(2.006), (I-746)+(1.043)+(2.007), (I-746)+(1.043)+(2.008), (I-746)+(1.043)+(2.009), (I-746)+(1.043)+(2.010), (I-746)+(1.043)+(2.011), (I-746)+(1.043)+(2.012), (I-746)+(1.043)+(2.013), (I-746)+(1.043)+(2.014), (I-746)+(1.043)+(2.015), (I-746)+(1.043)+(2.016), (I-746)+(1.043)+(2.017), (I-746)+(1.043)+(2.018), (I-746)+(1.043)+(2.019), (I-746)+(1.043)+(2.020), (I-746)+(1.043)+(2.021), (I-746)+(1.043)+(2.022), (I-746)+(1.043)+(2.023), (I-746)+(1.043)+(2.024), (I-746)+(1.043)+(2.025), (I-746)+(1.043)+(2.026), (I-746)+(1.043)+(2.027), (I-746)+(1.043)+(2.028), (I-746)+(1.043)+(2.029), (I-746)+(1.043)+(2.030), (I-746)+(1.043)+(2.031), (I-746)+(1.043)+(2.032), (I-746)+(1.043)+(2.033), (I-746)+(1.043)+(2.034), (I-746)+(1.043)+(2.035), (I-746)+(1.043)+(2.036), (I-746)+(1.043)+(2.037), (I-746)+(1.043)+(2.038), (I-746)+(1.043)+(2.039), (I-746)+(1.043)+(2.040), (I-746)+(1.043)+(2.041), (I-746)+(1.043)+(2.042), (I-746)+(1.043)+(2.043), (I-746)+(1.043)+(2.044), (I-746)+(1.043)+(2.045), (I-746)+(1.043)+(2.046), (I-746)+(1.043)+(2.047), (I-746)+(1.043)+(2.048), (I-746)+(1.043)+(2.049), (I-746)+(1.043)+(2.050), (I-746)+(1.043)+(2.051), (I-746)+(1.043)+(2.052), (I-746)+(1.043)+(2.053), (I-746)+(1.043)+(2.054), (I-746)+(1.043)+(2.055), (I-746)+(1.043)+(2.056), (I-746)+(1.043)+(2.057), (I-746)+(1.043)+(2.058), (I-746)+(1.043)+(2.059), (I-746)+(1.043)+(3.001), (I-746)+(1.043)+(3.002), (I-746)+(1.043)+(3.003), (I-746)+(1.043)+(3.004), (I-746)+(1.043)+(3.005), (I-746)+(1.043)+(3.006), (I-746)+(1.043)+(3.007), (I-746)+(1.043)+(3.008), (I-746)+(1.043)+(3.009), (I-746)+(1.043)+(3.010), (I-746)+(1.043)+(3.011), (I-746)+(1.043)+(3.012), (I-746)+(1.043)+(3.013), (I-746)+(1.043)+(3.014), (I-746)+(1.043)+(3.015), (I-746)+(1.043)+(3.016), (I-746)+(1.043)+(3.017), (I-746)+(1.043)+(3.018), (I-746)+(1.043)+(3.019), (I-746)+(1.043)+(3.020), (I-746)+(1.043)+(3.021), (I-746)+(1.043)+(3.022), (I-746)+(1.043)+(3.023), (I-746)+(1.043)+(3.024), (I-746)+(1.043)+(3.025), (I-746)+(1.043)+(3.026), (I-746)+(1.043)+(3.027), (I-746)+(1.043)+(3.028), (I-746)+(1.043)+(3.029), (I-746)+(1.043)+(3.030), (I-746)+(1.043)+(3.031), (I-746)+(1.043)+(5.001), (I-746)+(1.043)+(5.002), (I-746)+(1.043)+(5.003), (I-746)+(1.043)+(5.004), (I-746)+(1.043)+(5.005), (I-746)+(1.043)+(5.006), (I-746)+(1.043)+(5.007), (I-746)+(1.043)+(5.008), (I-746)+(1.043)+(5.009), (I-746)+(1.043)+(5.010), (I-746)+(1.043)+(5.011), (I-746)+(1.043)+(5.012), (I-746)+(1.043)+(5.013), (I-746)+(1.043)+(5.014), (I-746)+(1.043)+(5.015), (I-746)+(1.043)+(5.016), (I-746)+(1.043)+(5.017), (I-746)+(1.043)+(5.018), (I-746)+(1.043)+(5.019), (I-746)+(1.043)+(5.020), (I-746)+(1.043)+(5.021), (I-746)+(1.043)+(5.022), (I-746)+(1.043)+(5.023), (I-746)+(1.043)+(6.001), (I-746)+(1.043)+(6.002), (I-746)+(1.043)+(6.003), (I-746)+(1.043)+(6.004), (I-746)+(1.043)+(7.001), (I-746)+(1.043)+(7.002), (I-746)+(1.043)+(7.003), (I-746)+(1.043)+(7.004), (I-746)+(1.043)+(7.005), (I-746)+(1.043)+(7.006), (I-746)+(1.043)+(9.001), (I-746)+(1.043)+(9.002), (I-746)+(1.043)+(9.003), (I-746)+(1.043)+(9.004), (I-746)+(1.043)+(9.005), (I-746)+(1.043)+(9.006), (I-746)+(1.043)+(9.007), (I-746)+(1.043)+(9.008), (I-746)+(1.043)+(9.009), (I-746)+(1.043)+(14.001), (I-746)+(1.043)+(14.002), (I-746)+(1.043)+(15.008), (I-746)+(1.043)+(15.011), (I-746)+(1.043)+(15.012), (I-746)+(1.043)+(15.016), (I-746)+(1.043)+(15.025), (I-746)+(1.043)+(15.027), (I-746)+(1.043)+(15.047), (I-746)+(1.043)+(15.063), (I-746)+(1.043)+(15.064), (I-746)+(1.043)+(16.001), (I-746)+(1.043)+(16.002), (I-746)+(1.043)+(16.003), (I-746)+(1.043)+(16.004), (I-746)+(1.043)+(16.005), (I-746)+(1.043)+(16.006), (I-746)+(1.043)+(16.007), (I-746)+(1.043)+(16.008), (I-746)+(1.043)+(17.001), (I-746)+(1.043)+(17.002), (I-746)+(1.043)+(17.003), (I-746)+(1.043)+(17.004), (I-746)+(1.043)+(17.005), (I-746)+(1.043)+(17.006), (I-746)+(1.043)+(17.007), (I-746)+(1.043)+(17.008), (I-746)+(1.043)+(17.009), (I-746)+(1.043)+(17.010), (I-746)+(1.043)+(17.011), (I-746)+(1.043)+(17.012), (I-746)+(1.043)+(18.001),

(I-746)+(1.044)+(1.045), (I-746)+(1.044)+(1.046), (I-746)+(1.044)+(1.047), (I-746)+(1.044)+(1.048), (I-746)+(1.044)+(1.049), (I-746)+(1.044)+(1.050), (I-746)+(1.044)+(1.051), (I-746)+(1.044)+(1.052), (I-746)+(1.044)+(1.053), (I-746)+(1.044)+(1.054), (I-746)+(1.044)+(1.055), (I-746)+(1.044)+(1.056), (I-746)+(1.044)+(1.057), (I-746)+(1.044)+(1.058), (I-746)+(1.044)+(1.059), (I-746)+(1.044)+(1.060), (I-746)+(1.044)+(1.061), (I-746)+(1.044)+(1.062), (I-746)+(1.044)+(1.063), (I-746)+(1.044)+(1.064), (I-746)+(1.044)+(1.065), (I-746)+(1.044)+(1.066), (I-746)+(1.044)+(1.067), (I-746)+(1.044)+(1.068), (I-746)+(1.044)+(1.069), (I-746)+(1.044)+(1.070), (I-746)+(1.044)+(1.071), (I-746)+(1.044)+(1.072), (I-746)+(1.044)+(1.073), (I-746)+(1.044)+(1.074), (I-746)+(1.044)+(1.075), (I-746)+(1.044)+(1.076), (I-746)+(1.044)+(1.077), (I-746)+(1.044)+(1.078), (I-746)+(1.044)+(1.079), (I-746)+(1.044)+(1.080), (I-746)+(1.044)+(1.081), (I-746)+(1.044)+(1.082), (I-746)+(1.044)+(1.083), (I-746)+(1.044)+(1.084), (I-746)+(1.044)+(1.085), (I-746)+(1.044)+(1.086), (I-746)+(1.044)+(1.087), (I-746)+(1.044)+(1.088), (I-746)+(1.044)+(1.089), (I-746)+(1.044)+(1.090), (I-746)+(1.044)+(1.091), (I-746)+(1.044)+(1.092), (I-746)+(1.044)+(2.001), (I-746)+(1.044)+(2.002), (I-746)+(1.044)+(2.003), (I-746)+(1.044)+(2.004), (I-746)+(1.044)+(2.005), (I-746)+(1.044)+(2.006), (I-746)+(1.044)+(2.007), (I-746)+(1.044)+(2.008), (I-746)+(1.044)+(2.009), (I-746)+(1.044)+(2.010), (I-746)+(1.044)+(2.011), (I-746)+(1.044)+(2.012), (I-746)+(1.044)+(2.013), (I-746)+(1.044)+(2.014), (I-746)+(1.044)+(2.015), (I-746)+(1.044)+(2.016), (I-746)+(1.044)+(2.017), (I-746)+(1.044)+(2.018), (I-746)+(1.044)+(2.019), (I-746)+(1.044)+(2.020), (I-746)+(1.044)+(2.021), (I-746)+(1.044)+(2.022), (I-746)+(1.044)+(2.023), (I-746)+(1.044)+(2.024), (I-746)+(1.044)+(2.025), (I-746)+(1.044)+(2.026), (I-746)+(1.044)+(2.027), (I-746)+(1.044)+(2.028), (I-746)+(1.044)+(2.029), (I-746)+(1.044)+(2.030), (I-746)+(1.044)+(2.031), (I-746)+(1.044)+(2.032), (I-746)+(1.044)+(2.033), (I-746)+(1.044)+(2.034), (I-746)+(1.044)+(2.035), (I-746)+(1.044)+(2.036), (I-746)+(1.044)+(2.037), (I-746)+(1.044)+(2.038), (I-746)+(1.044)+(2.039), (I-746)+(1.044)+(2.040), (I-746)+(1.044)+(2.041), (I-746)+(1.044)+(2.042), (I-746)+(1.044)+(2.043), (I-746)+(1.044)+(2.044), (I-746)+(1.044)+(2.045), (I-746)+(1.044)+(2.046), (I-746)+(1.044)+(2.047), (I-746)+(1.044)+(2.048), (I-746)+(1.044)+(2.049), (I-746)+(1.044)+(2.050), (I-746)+(1.044)+(2.051), (I-746)+(1.044)+(2.052), (I-746)+(1.044)+(2.053), (I-746)+(1.044)+(2.054), (I-746)+(1.044)+(2.055), (I-746)+(1.044)+(2.056), (I-746)+(1.044)+(2.057), (I-746)+(1.044)+(2.058), (I-746)+(1.044)+(2.059), (I-746)+(1.044)+(3.001), (I-746)+(1.044)+(3.002), (I-746)+(1.044)+(3.003), (I-746)+(1.044)+(3.004), (I-746)+(1.044)+(3.005), (I-746)+(1.044)+(3.006), (I-746)+(1.044)+(3.007), (I-746)+(1.044)+(3.008), (I-746)+(1.044)+(3.009), (I-746)+(1.044)+(3.010), (I-746)+(1.044)+(3.011), (I-746)+(1.044)+(3.012), (I-746)+(1.044)+(3.013), (I-746)+(1.044)+(3.014), (I-746)+(1.044)+(3.015), (I-746)+(1.044)+(3.016), (I-746)+(1.044)+(3.017), (I-746)+(1.044)+(3.018), (I-746)+(1.044)+(3.019), (I-746)+(1.044)+(3.020), (I-746)+(1.044)+(3.021), (I-746)+(1.044)+(3.022), (I-746)+(1.044)+(3.023), (I-746)+(1.044)+(3.024), (I-746)+(1.044)+(3.025), (I-746)+(1.044)+(3.026), (I-746)+(1.044)+(3.027), (I-746)+(1.044)+(3.028), (I-746)+(1.044)+(3.029), (I-746)+(1.044)+(3.030), (I-746)+(1.044)+(3.031), (I-746)+(1.044)+(5.001), (I-746)+(1.044)+(5.002), (I-746)+(1.044)+(5.003), (I-746)+(1.044)+(5.004), (I-746)+(1.044)+(5.005), (I-746)+(1.044)+(5.006), (I-746)+(1.044)+(5.007), (I-746)+(1.044)+(5.008), (I-746)+(1.044)+(5.009), (I-746)+(1.044)+(5.010), (I-746)+(1.044)+(5.011), (I-746)+(1.044)+(5.012), (I-746)+(1.044)+(5.013), (I-746)+(1.044)+(5.014), (I-746)+(1.044)+(5.015), (I-746)+(1.044)+(5.016), (I-746)+(1.044)+(5.017), (I-746)+(1.044)+(5.018), (I-746)+(1.044)+(5.019), (I-746)+(1.044)+(5.020), (I-746)+(1.044)+(5.021), (I-746)+(1.044)+(5.022), (I-746)+(1.044)+(5.023), (I-746)+(1.044)+(6.001), (I-746)+(1.044)+(6.002), (I-746)+(1.044)+(6.003), (I-746)+(1.044)+(6.004), (I-746)+(1.044)+(7.001), (I-746)+(1.044)+(7.002), (I-746)+(1.044)+(7.003), (I-746)+(1.044)+(7.004), (I-746)+(1.044)+(7.005), (I-746)+(1.044)+(7.006), (I-746)+(1.044)+(9.001), (I-746)+(1.044)+(9.002), (I-746)+(1.044)+(9.003), (I-746)+(1.044)+(9.004), (I-746)+(1.044)+(9.005), (I-746)+(1.044)+(9.006), (I-746)+(1.044)+(9.007), (I-746)+(1.044)+(9.008), (I-746)+(1.044)+(9.009), (I-746)+(1.044)+(14.001), (I-746)+(1.044)+(14.002), (I-746)+(1.044)+(15.008), (I-746)+(1.044)+(15.011), (I-746)+(1.044)+(15.012), (I-746)+(1.044)+(15.016), (I-746)+(1.044)+(15.025), (I-746)+(1.044)+(15.027), (I-746)+(1.044)+(15.047), (I-746)+(1.044)+(15.063), (I-746)+(1.044)+(15.064), (I-746)+(1.044)+(16.001), (I-746)+(1.044)+(16.002), (I-746)+(1.044)+(16.003), (I-746)+(1.044)+(16.004), (I-746)+(1.044)+(16.005), (I-746)+(1.044)+(16.006), (I-746)+(1.044)+(16.007), (I-746)+(1.044)+(16.008), (I-746)+(1.044)+(17.001), (I-746)+(1.044)+(17.002), (I-746)+(1.044)+(17.003), (I-746)+(1.044)+(17.004), (I-746)+(1.044)+(17.005), (I-746)+(1.044)+(17.006), (I-746)+(1.044)+(17.007), (I-746)+(1.044)+(17.008), (I-746)+(1.044)+(17.009), (I-746)+(1.044)+(17.010), (I-746)+(1.044)+(17.011), (I-746)+(1.044)+(17.012), (I-746)+(1.044)+(18.001),

(I-746)+(1.045)+(1.046), (I-746)+(1.045)+(1.047), (I-746)+(1.045)+(1.048), (I-746)+(1.045)+(1.049), (I-746)+(1.045)+(1.050), (I-746)+(1.045)+(1.051), (I-746)+(1.045)+(1.052), (I-746)+(1.045)+(1.053), (I-746)+(1.045)+(1.054), (I-746)+(1.045)+(1.055), (I-746)+(1.045)+(1.056), (I-746)+(1.045)+(1.057), (I-746)+(1.045)+(1.058), (I-746)+(1.045)+(1.059), (I-746)+(1.045)+(1.060), (I-746)+(1.045)+(1.061), (I-746)+(1.045)+(1.062), (I-746)+(1.045)+(1.063), (I-746)+(1.045)+(1.064), (I-746)+(1.045)+(1.065), (I-746)+(1.045)+(1.066), (I-746)+(1.045)+(1.067), (I-746)+(1.045)+(1.068), (I-746)+(1.045)+(1.069), (I-746)+(1.045)+(1.070), (I-746)+(1.045)+(1.071), (I-746)+(1.045)+(1.072), (I-746)+(1.045)+(1.073), (I-746)+(1.045)+(1.074), (I-746)+(1.045)+(1.075), (I-746)+(1.045)+(1.076), (I-746)+(1.045)+(1.077), (I-746)+(1.045)+(1.078), (I-746)+(1.045)+(1.079), (I-746)+(1.045)+(1.080), (I-746)+(1.045)+(1.081), (I-746)+(1.045)+(1.082), (I-746)+(1.045)+(1.083), (I-746)+(1.045)+(1.084), (I-746)+(1.045)+(1.085), (I-746)+(1.045)+(1.086), (I-746)+(1.045)+(1.087), (I-746)+(1.045)+(1.088), (I-746)+(1.045)+(1.089), (I-746)+(1.045)+(1.090), (I-746)+(1.045)+(1.091), (I-746)+(1.045)+(1.092), (I-746)+(1.045)+(2.001), (I-746)+(1.045)+(2.002), (I-746)+(1.045)+(2.003), (I-746)+(1.045)+(2.004), (I-746)+(1.045)+(2.005), (I-746)+(1.045)+(2.006), (I-746)+(1.045)+(2.007), (I-746)+(1.045)+(2.008), (I-746)+(1.045)+(2.009), (I-746)+(1.045)+(2.010), (I-746)+(1.045)+(2.011), (I-746)+(1.045)+(2.012), (I-746)+(1.045)+(2.013), (I-746)+(1.045)+(2.014), (I-746)+(1.045)+(2.015), (I-746)+(1.045)+(2.016), (I-746)+(1.045)+(2.017), (I-746)+(1.045)+(2.018), (I-746)+(1.045)+(2.019), (I-746)+(1.045)+(2.020), (I-746)+(1.045)+(2.021), (I-746)+(1.045)+(2.022), (I-746)+(1.045)+(2.023), (I-746)+(1.045)+(2.024), (I-746)+(1.045)+(2.025), (I-746)+(1.045)+(2.026), (I-746)+(1.045)+(2.027), (I-746)+(1.045)+(2.028), (I-746)+(1.045)+(2.029), (I-746)+(1.045)+(2.030), (I-746)+(1.045)+(2.031), (I-746)+(1.045)+(2.032), (I-746)+(1.045)+(2.033), (I-746)+(1.045)+(2.034), (I-746)+(1.045)+(2.035), (I-746)+(1.045)+(2.036), (I-746)+(1.045)+(2.037), (I-746)+(1.045)+(2.038), (I-746)+(1.045)+(2.039), (I-746)+(1.045)+(2.040), (I-746)+(1.045)+(2.041), (I-746)+(1.045)+(2.042), (I-746)+(1.045)+(2.043), (I-746)+(1.045)+(2.044), (I-746)+(1.045)+(2.045), (I-746)+(1.045)+(2.046), (I-746)+(1.045)+(2.047), (I-746)+(1.045)+(2.048), (I-746)+(1.045)+(2.049), (I-746)+(1.045)+(2.050), (I-746)+(1.045)+(2.051), (I-746)+(1.045)+(2.052), (I-746)+(1.045)+(2.053), (I-746)+(1.045)+(2.054), (I-746)+(1.045)+(2.055), (I-746)+(1.045)+(2.056), (I-746)+(1.045)+(2.057), (I-746)+(1.045)+(2.058), (I-746)+(1.045)+(2.059), (I-746)+(1.045)+(3.001), (I-746)+(1.045)+(3.002), (I-746)+(1.045)+(3.003), (I-746)+(1.045)+(3.004), (I-746)+(1.045)+(3.005), (I-746)+(1.045)+(3.006), (I-746)+(1.045)+(3.007), (I-746)+(1.045)+(3.008), (I-746)+(1.045)+(3.009), (I-746)+(1.045)+(3.010), (I-746)+(1.045)+(3.011), (I-746)+(1.045)+(3.012), (I-746)+(1.045)+(3.013), (I-746)+(1.045)+(3.014), (I-746)+(1.045)+(3.015), (I-746)+(1.045)+(3.016), (I-746)+(1.045)+(3.017), (I-746)+(1.045)+(3.018), (I-746)+(1.045)+(3.019), (I-746)+(1.045)+(3.020), (I-746)+(1.045)+(3.021), (I-746)+(1.045)+(3.022), (I-746)+(1.045)+(3.023), (I-746)+(1.045)+(3.024), (I-746)+(1.045)+(3.025), (I-746)+(1.045)+(3.026), (I-746)+(1.045)+(3.027), (I-746)+(1.045)+(3.028), (I-746)+(1.045)+(3.029), (I-746)+(1.045)+(3.030), (I-746)+(1.045)+(3.031), (I-746)+(1.045)+(5.001), (I-746)+(1.045)+(5.002), (I-746)+(1.045)+(5.003), (I-746)+(1.045)+(5.004), (I-746)+(1.045)+(5.005), (I-746)+(1.045)+(5.006), (I-746)+(1.045)+(5.007), (I-746)+(1.045)+(5.008), (I-746)+(1.045)+(5.009), (I-746)+(1.045)+(5.010), (I-746)+(1.045)+(5.011), (I-746)+(1.045)+(5.012), (I-746)+(1.045)+(5.013), (I-746)+(1.045)+(5.014), (I-746)+(1.045)+(5.015), (I-746)+(1.045)+(5.016), (I-746)+(1.045)+(5.017), (I-746)+(1.045)+(5.018), (I-746)+(1.045)+(5.019), (I-746)+(1.045)+(5.020), (I-746)+(1.045)+(5.021), (I-746)+(1.045)+(5.022), (I-746)+(1.045)+(5.023), (I-746)+(1.045)+(6.001), (I-746)+(1.045)+(6.002), (I-746)+(1.045)+(6.003), (I-746)+(1.045)+(6.004), (I-746)+(1.045)+(7.001), (I-746)+(1.045)+(7.002), (I-746)+(1.045)+(7.003), (I-746)+(1.045)+(7.004), (I-746)+(1.045)+(7.005), (I-746)+(1.045)+(7.006), (I-746)+(1.045)+(9.001), (I-746)+(1.045)+(9.002), (I-746)+(1.045)+(9.003), (I-746)+(1.045)+(9.004), (I-746)+(1.045)+(9.005), (I-746)+(1.045)+(9.006), (I-746)+(1.045)+(9.007), (I-746)+(1.045)+(9.008), (I-746)+(1.045)+(9.009), (I-746)+(1.045)+(14.001), (I-746)+(1.045)+(14.002), (I-746)+(1.045)+(15.008), (I-746)+(1.045)+(15.011), (I-746)+(1.045)+(15.012), (I-746)+(1.045)+(15.016), (I-746)+(1.045)+(15.025), (I-746)+(1.045)+(15.027), (I-746)+(1.045)+(15.047), (I-746)+(1.045)+(15.063), (I-746)+(1.045)+(15.064), (I-746)+(1.045)+(16.001), (I-746)+(1.045)+(16.002), (I-746)+(1.045)+(16.003), (I-746)+(1.045)+(16.004), (I-746)+(1.045)+(16.005), (I-746)+(1.045)+(16.006), (I-746)+(1.045)+(16.007), (I-746)+(1.045)+(16.008), (I-746)+(1.045)+(17.001), (I-746)+(1.045)+(17.002), (I-746)+(1.045)+(17.003), (I-746)+(1.045)+(17.004), (I-746)+(1.045)+(17.005), (I-746)+(1.045)+(17.006), (I-746)+(1.045)+(17.007), (I-746)+(1.045)+(17.008), (I-746)+(1.045)+(17.009), (I-746)+(1.045)+(17.010), (I-746)+(1.045)+(17.011), (I-746)+(1.045)+(17.012), (I-746)+(1.045)+(18.001),

(I-746)+(1.046)+(1.047), (I-746)+(1.046)+(1.048), (I-746)+(1.046)+(1.049), (I-746)+(1.046)+(1.050), (I-746)+(1.046)+(1.051), (I-746)+(1.046)+(1.052), (I-746)+(1.046)+(1.053), (I-746)+(1.046)+(1.054), (I-746)+(1.046)+(1.055), (I-746)+(1.046)+(1.056), (I-746)+(1.046)+(1.057), (I-746)+(1.046)+(1.058), (I-746)+(1.046)+(1.059), (I-746)+(1.046)+(1.060), (I-746)+(1.046)+(1.061), (I-746)+(1.046)+(1.062), (I-746)+(1.046)+(1.063), (I-746)+(1.046)+(1.064), (I-746)+(1.046)+(1.065), (I-746)+(1.046)+(1.066), (I-746)+(1.046)+(1.067), (I-746)+(1.046)+(1.068), (I-746)+(1.046)+(1.069), (I-746)+(1.046)+(1.070), (I-746)+(1.046)+(1.071), (I-746)+(1.046)+(1.072), (I-746)+(1.046)+(1.073), (I-746)+(1.046)+(1.074), (I-746)+(1.046)+(1.075), (I-746)+(1.046)+(1.076), (I-746)+(1.046)+(1.077), (I-746)+(1.046)+(1.078), (I-746)+(1.046)+(1.079), (I-746)+(1.046)+(1.080), (I-746)+(1.046)+(1.081), (I-746)+(1.046)+(1.082), (I-746)+(1.046)+(1.083), (I-746)+(1.046)+(1.084), (I-746)+(1.046)+(1.085), (I-746)+(1.046)+(1.086), (I-746)+(1.046)+(1.087), (I-746)+(1.046)+(1.088), (I-746)+(1.046)+(1.089), (I-746)+(1.046)+(1.090), (I-746)+(1.046)+(1.091), (I-746)+(1.046)+(1.092), (I-746)+(1.046)+(2.001), (I-746)+(1.046)+(2.002), (I-746)+(1.046)+(2.003), (I-746)+(1.046)+(2.004), (I-746)+(1.046)+(2.005), (I-746)+(1.046)+(2.006), (I-746)+(1.046)+(2.007), (I-746)+(1.046)+(2.008), (I-746)+(1.046)+(2.009), (I-746)+(1.046)+(2.010), (I-746)+(1.046)+(2.011), (I-746)+(1.046)+(2.012), (I-746)+(1.046)+(2.013), (I-746)+(1.046)+(2.014), (I-746)+(1.046)+(2.015), (I-746)+(1.046)+(2.016), (I-746)+(1.046)+(2.017), (I-746)+(1.046)+(2.018), (I-746)+(1.046)+(2.019), (I-746)+(1.046)+(2.020), (I-746)+(1.046)+(2.021), (I-746)+(1.046)+(2.022), (I-746)+(1.046)+(2.023), (I-746)+(1.046)+(2.024), (I-746)+(1.046)+(2.025), (I-746)+(1.046)+(2.026), (I-746)+(1.046)+(2.027), (I-746)+(1.046)+(2.028), (I-746)+(1.046)+(2.029), (I-746)+(1.046)+(2.030), (I-746)+(1.046)+(2.031), (I-746)+(1.046)+(2.032), (I-746)+(1.046)+(2.033), (I-746)+(1.046)+(2.034), (I-746)+(1.046)+(2.035), (I-746)+(1.046)+(2.036), (I-746)+(1.046)+(2.037), (I-746)+(1.046)+(2.038), (I-746)+(1.046)+(2.039), (I-746)+(1.046)+(2.040), (I-746)+(1.046)+(2.041), (I-746)+(1.046)+(2.042), (I-746)+(1.046)+(2.043), (I-746)+(1.046)+(2.044), (I-746)+(1.046)+(2.045), (I-746)+(1.046)+(2.046), (I-746)+(1.046)+(2.047), (I-746)+(1.046)+(2.048), (I-746)+(1.046)+(2.049), (I-746)+(1.046)+(2.050), (I-746)+(1.046)+(2.051), (I-746)+(1.046)+(2.052), (I-746)+(1.046)+(2.053), (I-746)+(1.046)+(2.054), (I-746)+(1.046)+(2.055), (I-746)+(1.046)+(2.056), (I-746)+(1.046)+(2.057), (I-746)+(1.046)+(2.058), (I-746)+(1.046)+(2.059), (I-746)+(1.046)+(3.001), (I-746)+(1.046)+(3.002), (I-746)+(1.046)+(3.003), (I-746)+(1.046)+(3.004), (I-746)+(1.046)+(3.005), (I-746)+(1.046)+(3.006), (I-746)+(1.046)+(3.007), (I-746)+(1.046)+(3.008), (I-746)+(1.046)+(3.009), (I-746)+(1.046)+(3.010), (I-746)+(1.046)+(3.011), (I-746)+(1.046)+(3.012), (I-746)+(1.046)+(3.013), (I-746)+(1.046)+(3.014), (I-746)+(1.046)+(3.015), (I-746)+(1.046)+(3.016), (I-746)+(1.046)+(3.017), (I-746)+(1.046)+(3.018), (I-746)+(1.046)+(3.019), (I-746)+(1.046)+(3.020), (I-746)+(1.046)+(3.021), (I-746)+(1.046)+(3.022), (I-746)+(1.046)+(3.023), (I-746)+(1.046)+(3.024), (I-746)+(1.046)+(3.025), (I-746)+(1.046)+(3.026), (I-746)+(1.046)+(3.027), (I-746)+(1.046)+(3.028), (I-746)+(1.046)+(3.029), (I-746)+(1.046)+(3.030), (I-746)+(1.046)+(3.031), (I-746)+(1.046)+(5.001), (I-746)+(1.046)+(5.002), (I-746)+(1.046)+(5.003), (I-746)+(1.046)+(5.004), (I-746)+(1.046)+(5.005), (I-746)+(1.046)+(5.006), (I-746)+(1.046)+(5.007), (I-746)+(1.046)+(5.008), (I-746)+(1.046)+(5.009), (I-746)+(1.046)+(5.010), (I-746)+(1.046)+(5.011), (I-746)+(1.046)+(5.012), (I-746)+(1.046)+(5.013), (I-746)+(1.046)+(5.014), (I-746)+(1.046)+(5.015), (I-746)+(1.046)+(5.016), (I-746)+(1.046)+(5.017), (I-746)+(1.046)+(5.018), (I-746)+(1.046)+(5.019), (I-746)+(1.046)+(5.020), (I-746)+(1.046)+(5.021), (I-746)+(1.046)+(5.022), (I-746)+(1.046)+(5.023), (I-746)+(1.046)+(6.001), (I-746)+(1.046)+(6.002), (I-746)+(1.046)+(6.003), (I-746)+(1.046)+(6.004), (I-746)+(1.046)+(7.001), (I-746)+(1.046)+(7.002), (I-746)+(1.046)+(7.003), (I-746)+(1.046)+(7.004), (I-746)+(1.046)+(7.005), (I-746)+(1.046)+(7.006), (I-746)+(1.046)+(9.001), (I-746)+(1.046)+(9.002), (I-746)+(1.046)+(9.003), (I-746)+(1.046)+(9.004), (I-746)+(1.046)+(9.005), (I-746)+(1.046)+(9.006), (I-746)+(1.046)+(9.007), (I-746)+(1.046)+(9.008), (I-746)+(1.046)+(9.009), (I-746)+(1.046)+(14.001), (I-746)+(1.046)+(14.002), (I-746)+(1.046)+(15.008), (I-746)+(1.046)+(15.011), (I-746)+(1.046)+(15.012), (I-746)+(1.046)+(15.016), (I-746)+(1.046)+(15.025), (I-746)+(1.046)+(15.027), (I-746)+(1.046)+(15.047), (I-746)+(1.046)+(15.063), (I-746)+(1.046)+(15.064), (I-746)+(1.046)+(16.001), (I-746)+(1.046)+(16.002), (I-746)+(1.046)+(16.003), (I-746)+(1.046)+(16.004), (I-746)+(1.046)+(16.005), (I-746)+(1.046)+(16.006), (I-746)+(1.046)+(16.007), (I-746)+(1.046)+(16.008), (I-746)+(1.046)+(17.001), (I-746)+(1.046)+(17.002), (I-746)+(1.046)+(17.003), (I-746)+(1.046)+(17.004), (I-746)+(1.046)+(17.005), (I-746)+(1.046)+(17.006), (I-746)+(1.046)+(17.007), (I-746)+(1.046)+(17.008), (I-746)+(1.046)+(17.009), (I-746)+(1.046)+(17.010), (I-746)+(1.046)+(17.011), (I-746)+(1.046)+(17.012), (I-746)+(1.046)+(18.001),

(I-746)+(1.047)+(1.048), (I-746)+(1.047)+(1.049), (I-746)+(1.047)+(1.050), (I-746)+(1.047)+(1.051), (I-746)+(1.047)+(1.052), (I-746)+(1.047)+(1.053), (I-746)+(1.047)+(1.054), (I-746)+(1.047)+(1.055), (I-746)+(1.047)+(1.056), (I-746)+(1.047)+(1.057), (I-746)+(1.047)+(1.058), (I-746)+(1.047)+(1.059), (I-746)+(1.047)+(1.060), (I-746)+(1.047)+(1.061), (I-746)+(1.047)+(1.062), (I-746)+(1.047)+(1.063), (I-746)+(1.047)+(1.064), (I-746)+(1.047)+(1.065), (I-746)+(1.047)+(1.066), (I-746)+(1.047)+(1.067), (I-746)+(1.047)+(1.068), (I-746)+(1.047)+(1.069), (I-746)+(1.047)+(1.070), (I-746)+(1.047)+(1.071), (I-746)+(1.047)+(1.072), (I-746)+(1.047)+(1.073), (I-746)+(1.047)+(1.074), (I-746)+(1.047)+(1.075), (I-746)+(1.047)+(1.076), (I-746)+(1.047)+(1.077), (I-746)+(1.047)+(1.078), (I-746)+(1.047)+(1.079), (I-746)+(1.047)+(1.080), (I-746)+(1.047)+(1.081), (I-746)+(1.047)+(1.082), (I-746)+(1.047)+(1.083), (I-746)+(1.047)+(1.084), (I-746)+(1.047)+(1.085), (I-746)+(1.047)+(1.086), (I-746)+(1.047)+(1.087), (I-746)+(1.047)+(1.088), (I-746)+(1.047)+(1.089), (I-746)+(1.047)+(1.090), (I-746)+(1.047)+(1.091), (I-746)+(1.047)+(1.092), (I-746)+(1.047)+(2.001), (I-746)+(1.047)+(2.002), (I-746)+(1.047)+(2.003), (I-746)+(1.047)+(2.004), (I-746)+(1.047)+(2.005), (I-746)+(1.047)+(2.006), (I-746)+(1.047)+(2.007), (I-746)+(1.047)+(2.008), (I-746)+(1.047)+(2.009), (I-746)+(1.047)+(2.010), (I-746)+(1.047)+(2.011), (I-746)+(1.047)+(2.012), (I-746)+(1.047)+(2.013), (I-746)+(1.047)+(2.014), (I-746)+(1.047)+(2.015), (I-746)+(1.047)+(2.016), (I-746)+(1.047)+(2.017), (I-746)+(1.047)+(2.018), (I-746)+(1.047)+(2.019), (I-746)+(1.047)+(2.020), (I-746)+(1.047)+(2.021), (I-746)+(1.047)+(2.022), (I-746)+(1.047)+(2.023), (I-746)+(1.047)+(2.024), (I-746)+(1.047)+(2.025), (I-746)+(1.047)+(2.026), (I-746)+(1.047)+(2.027), (I-746)+(1.047)+(2.028), (I-746)+(1.047)+(2.029), (I-746)+(1.047)+(2.030), (I-746)+(1.047)+(2.031), (I-746)+(1.047)+(2.032), (I-746)+(1.047)+(2.033), (I-746)+(1.047)+(2.034), (I-746)+(1.047)+(2.035), (I-746)+(1.047)+(2.036), (I-746)+(1.047)+(2.037), (I-746)+(1.047)+(2.038), (I-746)+(1.047)+(2.039), (I-746)+(1.047)+(2.040), (I-746)+(1.047)+(2.041), (I-746)+(1.047)+(2.042), (I-746)+(1.047)+(2.043), (I-746)+(1.047)+(2.044), (I-746)+(1.047)+(2.045), (I-746)+(1.047)+(2.046), (I-746)+(1.047)+(2.047), (I-746)+(1.047)+(2.048), (I-746)+(1.047)+(2.049), (I-746)+(1.047)+(2.050), (I-746)+(1.047)+(2.051), (I-746)+(1.047)+(2.052), (I-746)+(1.047)+(2.053), (I-746)+(1.047)+(2.054), (I-746)+(1.047)+(2.055), (I-746)+(1.047)+(2.056), (I-746)+(1.047)+(2.057), (I-746)+(1.047)+(2.058), (I-746)+(1.047)+(2.059), (I-746)+(1.047)+(3.001), (I-746)+(1.047)+(3.002), (I-746)+(1.047)+(3.003), (I-746)+(1.047)+(3.004), (I-746)+(1.047)+(3.005), (I-746)+(1.047)+(3.006), (I-746)+(1.047)+(3.007), (I-746)+(1.047)+(3.008), (I-746)+(1.047)+(3.009), (I-746)+(1.047)+(3.010), (I-746)+(1.047)+(3.011), (I-746)+(1.047)+(3.012), (I-746)+(1.047)+(3.013), (I-746)+(1.047)+(3.014), (I-746)+(1.047)+(3.015), (I-746)+(1.047)+(3.016), (I-746)+(1.047)+(3.017), (I-746)+(1.047)+(3.018), (I-746)+(1.047)+(3.019), (I-746)+(1.047)+(3.020), (I-746)+(1.047)+(3.021), (I-746)+(1.047)+(3.022), (I-746)+(1.047)+(3.023), (I-746)+(1.047)+(3.024), (I-746)+(1.047)+(3.025), (I-746)+(1.047)+(3.026), (I-746)+(1.047)+(3.027), (I-746)+(1.047)+(3.028), (I-746)+(1.047)+(3.029), (I-746)+(1.047)+(3.030), (I-746)+(1.047)+(3.031), (I-746)+(1.047)+(5.001), (I-746)+(1.047)+(5.002), (I-746)+(1.047)+(5.003), (I-746)+(1.047)+(5.004), (I-746)+(1.047)+(5.005), (I-746)+(1.047)+(5.006), (I-746)+(1.047)+(5.007), (I-746)+(1.047)+(5.008), (I-746)+(1.047)+(5.009), (I-746)+(1.047)+(5.010), (I-746)+(1.047)+(5.011), (I-746)+(1.047)+(5.012), (I-746)+(1.047)+(5.013), (I-746)+(1.047)+(5.014), (I-746)+(1.047)+(5.015), (I-746)+(1.047)+(5.016), (I-746)+(1.047)+(5.017), (I-746)+(1.047)+(5.018), (I-746)+(1.047)+(5.019), (I-746)+(1.047)+(5.020), (I-746)+(1.047)+(5.021), (I-746)+(1.047)+(5.022), (I-746)+(1.047)+(5.023), (I-746)+(1.047)+(6.001), (I-746)+(1.047)+(6.002), (I-746)+(1.047)+(6.003), (I-746)+(1.047)+(6.004), (I-746)+(1.047)+(7.001), (I-746)+(1.047)+(7.002), (I-746)+(1.047)+(7.003), (I-746)+(1.047)+(7.004), (I-746)+(1.047)+(7.005), (I-746)+(1.047)+(7.006), (I-746)+(1.047)+(9.001), (I-746)+(1.047)+(9.002), (I-746)+(1.047)+(9.003), (I-746)+(1.047)+(9.004), (I-746)+(1.047)+(9.005), (I-746)+(1.047)+(9.006), (I-746)+(1.047)+(9.007), (I-746)+(1.047)+(9.008), (I-746)+(1.047)+(9.009), (I-746)+(1.047)+(14.001), (I-746)+(1.047)+(14.002), (I-746)+(1.047)+(15.008), (I-746)+(1.047)+(15.011), (I-746)+(1.047)+(15.012), (I-746)+(1.047)+(15.016), (I-746)+(1.047)+(15.025), (I-746)+(1.047)+(15.027), (I-746)+(1.047)+(15.047), (I-746)+(1.047)+(15.063), (I-746)+(1.047)+(15.064), (I-746)+(1.047)+(16.001), (I-746)+(1.047)+(16.002), (I-746)+(1.047)+(16.003), (I-746)+(1.047)+(16.004), (I-746)+(1.047)+(16.005), (I-746)+(1.047)+(16.006), (I-746)+(1.047)+(16.007), (I-746)+(1.047)+(16.008), (I-746)+(1.047)+(17.001), (I-746)+(1.047)+(17.002), (I-746)+(1.047)+(17.003), (I-746)+(1.047)+(17.004), (I-746)+(1.047)+(17.005), (I-746)+(1.047)+(17.006), (I-746)+(1.047)+(17.007), (I-746)+(1.047)+(17.008), (I-746)+(1.047)+(17.009), (I-746)+(1.047)+(17.010), (I-746)+(1.047)+(17.011), (I-746)+(1.047)+(17.012), (I-746)+(1.047)+(18.001),

(I-746)+(1.048)+(1.049), (I-746)+(1.048)+(1.050), (I-746)+(1.048)+(1.051), (I-746)+(1.048)+(1.052), (I-746)+(1.048)+(1.053), (I-746)+(1.048)+(1.054), (I-746)+(1.048)+(1.055), (I-746)+(1.048)+(1.056), (I-746)+(1.048)+(1.057), (I-746)+(1.048)+(1.058), (I-746)+(1.048)+(1.059), (I-746)+(1.048)+(1.060), (I-746)+(1.048)+(1.061), (I-746)+(1.048)+(1.062), (I-746)+(1.048)+(1.063), (I-746)+(1.048)+(1.064), (I-746)+(1.048)+(1.065), (I-746)+(1.048)+(1.066), (I-746)+(1.048)+(1.067), (I-746)+(1.048)+(1.068), (I-746)+(1.048)+(1.069), (I-746)+(1.048)+(1.070), (I-746)+(1.048)+(1.071), (I-746)+(1.048)+(1.072), (I-746)+(1.048)+(1.073), (I-746)+(1.048)+(1.074), (I-746)+(1.048)+(1.075), (I-746)+(1.048)+(1.076), (I-746)+(1.048)+(1.077), (I-746)+(1.048)+(1.078), (I-746)+(1.048)+(1.079), (I-746)+(1.048)+(1.080), (I-746)+(1.048)+(1.081), (I-746)+(1.048)+(1.082), (I-746)+(1.048)+(1.083), (I-746)+(1.048)+(1.084), (I-746)+(1.048)+(1.085), (I-746)+(1.048)+(1.086), (I-746)+(1.048)+(1.087), (I-746)+(1.048)+(1.088), (I-746)+(1.048)+(1.089), (I-746)+(1.048)+(1.090), (I-746)+(1.048)+(1.091), (I-746)+(1.048)+(1.092), (I-746)+(1.048)+(2.001), (I-746)+(1.048)+(2.002), (I-746)+(1.048)+(2.003), (I-746)+(1.048)+(2.004), (I-746)+(1.048)+(2.005), (I-746)+(1.048)+(2.006), (I-746)+(1.048)+(2.007), (I-746)+(1.048)+(2.008), (I-746)+(1.048)+(2.009), (I-746)+(1.048)+(2.010), (I-746)+(1.048)+(2.011), (I-746)+(1.048)+(2.012), (I-746)+(1.048)+(2.013), (I-746)+(1.048)+(2.014), (I-746)+(1.048)+(2.015), (I-746)+(1.048)+(2.016), (I-746)+(1.048)+(2.017), (I-746)+(1.048)+(2.018), (I-746)+(1.048)+(2.019), (I-746)+(1.048)+(2.020), (I-746)+(1.048)+(2.021), (I-746)+(1.048)+(2.022), (I-746)+(1.048)+(2.023), (I-746)+(1.048)+(2.024), (I-746)+(1.048)+(2.025), (I-746)+(1.048)+(2.026), (I-746)+(1.048)+(2.027), (I-746)+(1.048)+(2.028), (I-746)+(1.048)+(2.029), (I-746)+(1.048)+(2.030), (I-746)+(1.048)+(2.031), (I-746)+(1.048)+(2.032), (I-746)+(1.048)+(2.033), (I-746)+(1.048)+(2.034), (I-746)+(1.048)+(2.035), (I-746)+(1.048)+(2.036), (I-746)+(1.048)+(2.037), (I-746)+(1.048)+(2.038), (I-746)+(1.048)+(2.039), (I-746)+(1.048)+(2.040), (I-746)+(1.048)+(2.041), (I-746)+(1.048)+(2.042), (I-746)+(1.048)+(2.043), (I-746)+(1.048)+(2.044), (I-746)+(1.048)+(2.045), (I-746)+(1.048)+(2.046), (I-746)+(1.048)+(2.047), (I-746)+(1.048)+(2.048), (I-746)+(1.048)+(2.049), (I-746)+(1.048)+(2.050), (I-746)+(1.048)+(2.051), (I-746)+(1.048)+(2.052), (I-746)+(1.048)+(2.053), (I-746)+(1.048)+(2.054), (I-746)+(1.048)+(2.055), (I-746)+(1.048)+(2.056), (I-746)+(1.048)+(2.057), (I-746)+(1.048)+(2.058), (I-746)+(1.048)+(2.059), (I-746)+(1.048)+(3.001), (I-746)+(1.048)+(3.002), (I-746)+(1.048)+(3.003), (I-746)+(1.048)+(3.004), (I-746)+(1.048)+(3.005), (I-746)+(1.048)+(3.006), (I-746)+(1.048)+(3.007), (I-746)+(1.048)+(3.008), (I-746)+(1.048)+(3.009), (I-746)+(1.048)+(3.010), (I-746)+(1.048)+(3.011), (I-746)+(1.048)+(3.012), (I-746)+(1.048)+(3.013), (I-746)+(1.048)+(3.014), (I-746)+(1.048)+(3.015), (I-746)+(1.048)+(3.016), (I-746)+(1.048)+(3.017), (I-746)+(1.048)+(3.018), (I-746)+(1.048)+(3.019), (I-746)+(1.048)+(3.020), (I-746)+(1.048)+(3.021), (I-746)+(1.048)+(3.022), (I-746)+(1.048)+(3.023), (I-746)+(1.048)+(3.024), (I-746)+(1.048)+(3.025), (I-746)+(1.048)+(3.026), (I-746)+(1.048)+(3.027), (I-746)+(1.048)+(3.028), (I-746)+(1.048)+(3.029), (I-746)+(1.048)+(3.030), (I-746)+(1.048)+(3.031), (I-746)+(1.048)+(5.001), (I-746)+(1.048)+(5.002), (I-746)+(1.048)+(5.003), (I-746)+(1.048)+(5.004), (I-746)+(1.048)+(5.005), (I-746)+(1.048)+(5.006), (I-746)+(1.048)+(5.007), (I-746)+(1.048)+(5.008), (I-746)+(1.048)+(5.009), (I-746)+(1.048)+(5.010), (I-746)+(1.048)+(5.011), (I-746)+(1.048)+(5.012), (I-746)+(1.048)+(5.013), (I-746)+(1.048)+(5.014), (I-746)+(1.048)+(5.015), (I-746)+(1.048)+(5.016), (I-746)+(1.048)+(5.017), (I-746)+(1.048)+(5.018), (I-746)+(1.048)+(5.019), (I-746)+(1.048)+(5.020), (I-746)+(1.048)+(5.021), (I-746)+(1.048)+(5.022), (I-746)+(1.048)+(5.023), (I-746)+(1.048)+(6.001), (I-746)+(1.048)+(6.002), (I-746)+(1.048)+(6.003), (I-746)+(1.048)+(6.004), (I-746)+(1.048)+(7.001), (I-746)+(1.048)+(7.002), (I-746)+(1.048)+(7.003), (I-746)+(1.048)+(7.004), (I-746)+(1.048)+(7.005), (I-746)+(1.048)+(7.006), (I-746)+(1.048)+(9.001), (I-746)+(1.048)+(9.002), (I-746)+(1.048)+(9.003), (I-746)+(1.048)+(9.004), (I-746)+(1.048)+(9.005), (I-746)+(1.048)+(9.006), (I-746)+(1.048)+(9.007), (I-746)+(1.048)+(9.008), (I-746)+(1.048)+(9.009), (I-746)+(1.048)+(14.001), (I-746)+(1.048)+(14.002), (I-746)+(1.048)+(15.008), (I-746)+(1.048)+(15.011), (I-746)+(1.048)+(15.012), (I-746)+(1.048)+(15.016), (I-746)+(1.048)+(15.025), (I-746)+(1.048)+(15.027), (I-746)+(1.048)+(15.047), (I-746)+(1.048)+(15.063), (I-746)+(1.048)+(15.064), (I-746)+(1.048)+(16.001), (I-746)+(1.048)+(16.002), (I-746)+(1.048)+(16.003), (I-746)+(1.048)+(16.004), (I-746)+(1.048)+(16.005), (I-746)+(1.048)+(16.006), (I-746)+(1.048)+(16.007), (I-746)+(1.048)+(16.008), (I-746)+(1.048)+(17.001), (I-746)+(1.048)+(17.002), (I-746)+(1.048)+(17.003), (I-746)+(1.048)+(17.004), (I-746)+(1.048)+(17.005), (I-746)+(1.048)+(17.006), (I-746)+(1.048)+(17.007), (I-746)+(1.048)+(17.008), (I-746)+(1.048)+(17.009), (I-746)+(1.048)+(17.010), (I-746)+(1.048)+(17.011), (I-746)+(1.048)+(17.012), (I-746)+(1.048)+(18.001),

(I-746)+(1.049)+(1.050), (I-746)+(1.049)+(1.051), (I-746)+(1.049)+(1.052), (I-746)+(1.049)+(1.053), (I-746)+(1.049)+(1.054), (I-746)+(1.049)+(1.055), (I-746)+(1.049)+(1.056), (I-746)+(1.049)+(1.057), (I-746)+(1.049)+(1.058), (I-746)+(1.049)+(1.059), (I-746)+(1.049)+(1.060), (I-746)+(1.049)+(1.061), (I-746)+(1.049)+(1.062), (I-746)+(1.049)+(1.063), (I-746)+(1.049)+(1.064), (I-746)+(1.049)+(1.065), (I-746)+(1.049)+(1.066), (I-746)+(1.049)+(1.067), (I-746)+(1.049)+(1.068), (I-746)+(1.049)+(1.069), (I-746)+(1.049)+(1.070), (I-746)+(1.049)+(1.071), (I-746)+(1.049)+(1.072), (I-746)+(1.049)+(1.073), (I-746)+(1.049)+(1.074), (I-746)+(1.049)+(1.075), (I-746)+(1.049)+(1.076), (I-746)+(1.049)+(1.077), (I-746)+(1.049)+(1.078), (I-746)+(1.049)+(1.079), (I-746)+(1.049)+(1.080), (I-746)+(1.049)+(1.081), (I-746)+(1.049)+(1.082), (I-746)+(1.049)+(1.083), (I-746)+(1.049)+(1.084), (I-746)+(1.049)+(1.085), (I-746)+(1.049)+(1.086), (I-746)+(1.049)+(1.087), (I-746)+(1.049)+(1.088), (I-746)+(1.049)+(1.089), (I-746)+(1.049)+(1.090), (I-746)+(1.049)+(1.091), (I-746)+(1.049)+(1.092), (I-746)+(1.049)+(2.001), (I-746)+(1.049)+(2.002), (I-746)+(1.049)+(2.003), (I-746)+(1.049)+(2.004), (I-746)+(1.049)+(2.005), (I-746)+(1.049)+(2.006), (I-746)+(1.049)+(2.007), (I-746)+(1.049)+(2.008), (I-746)+(1.049)+(2.009), (I-746)+(1.049)+(2.010), (I-746)+(1.049)+(2.011), (I-746)+(1.049)+(2.012), (I-746)+(1.049)+(2.013), (I-746)+(1.049)+(2.014), (I-746)+(1.049)+(2.015), (I-746)+(1.049)+(2.016), (I-746)+(1.049)+(2.017), (I-746)+(1.049)+(2.018), (I-746)+(1.049)+(2.019), (I-746)+(1.049)+(2.020), (I-746)+(1.049)+(2.021), (I-746)+(1.049)+(2.022), (I-746)+(1.049)+(2.023), (I-746)+(1.049)+(2.024), (I-746)+(1.049)+(2.025), (I-746)+(1.049)+(2.026), (I-746)+(1.049)+(2.027), (I-746)+(1.049)+(2.028), (I-746)+(1.049)+(2.029), (I-746)+(1.049)+(2.030), (I-746)+(1.049)+(2.031), (I-746)+(1.049)+(2.032), (I-746)+(1.049)+(2.033), (I-746)+(1.049)+(2.034), (I-746)+(1.049)+(2.035), (I-746)+(1.049)+(2.036), (I-746)+(1.049)+(2.037), (I-746)+(1.049)+(2.038), (I-746)+(1.049)+(2.039), (I-746)+(1.049)+(2.040), (I-746)+(1.049)+(2.041), (I-746)+(1.049)+(2.042), (I-746)+(1.049)+(2.043), (I-746)+(1.049)+(2.044), (I-746)+(1.049)+(2.045), (I-746)+(1.049)+(2.046), (I-746)+(1.049)+(2.047), (I-746)+(1.049)+(2.048), (I-746)+(1.049)+(2.049), (I-746)+(1.049)+(2.050), (I-746)+(1.049)+(2.051), (I-746)+(1.049)+(2.052), (I-746)+(1.049)+(2.053), (I-746)+(1.049)+(2.054), (I-746)+(1.049)+(2.055), (I-746)+(1.049)+(2.056), (I-746)+(1.049)+(2.057), (I-746)+(1.049)+(2.058), (I-746)+(1.049)+(2.059), (I-746)+(1.049)+(3.001), (I-746)+(1.049)+(3.002), (I-746)+(1.049)+(3.003), (I-746)+(1.049)+(3.004), (I-746)+(1.049)+(3.005), (I-746)+(1.049)+(3.006), (I-746)+(1.049)+(3.007), (I-746)+(1.049)+(3.008), (I-746)+(1.049)+(3.009), (I-746)+(1.049)+(3.010), (I-746)+(1.049)+(3.011), (I-746)+(1.049)+(3.012), (I-746)+(1.049)+(3.013), (I-746)+(1.049)+(3.014), (I-746)+(1.049)+(3.015), (I-746)+(1.049)+(3.016), (I-746)+(1.049)+(3.017), (I-746)+(1.049)+(3.018), (I-746)+(1.049)+(3.019), (I-746)+(1.049)+(3.020), (I-746)+(1.049)+(3.021), (I-746)+(1.049)+(3.022), (I-746)+(1.049)+(3.023), (I-746)+(1.049)+(3.024), (I-746)+(1.049)+(3.025), (I-746)+(1.049)+(3.026), (I-746)+(1.049)+(3.027), (I-746)+(1.049)+(3.028), (I-746)+(1.049)+(3.029), (I-746)+(1.049)+(3.030), (I-746)+(1.049)+(3.031), (I-746)+(1.049)+(5.001), (I-746)+(1.049)+(5.002), (I-746)+(1.049)+(5.003), (I-746)+(1.049)+(5.004), (I-746)+(1.049)+(5.005), (I-746)+(1.049)+(5.006), (I-746)+(1.049)+(5.007), (I-746)+(1.049)+(5.008), (I-746)+(1.049)+(5.009), (I-746)+(1.049)+(5.010), (I-746)+(1.049)+(5.011), (I-746)+(1.049)+(5.012), (I-746)+(1.049)+(5.013), (I-746)+(1.049)+(5.014), (I-746)+(1.049)+(5.015), (I-746)+(1.049)+(5.016), (I-746)+(1.049)+(5.017), (I-746)+(1.049)+(5.018), (I-746)+(1.049)+(5.019), (I-746)+(1.049)+(5.020), (I-746)+(1.049)+(5.021), (I-746)+(1.049)+(5.022), (I-746)+(1.049)+(5.023), (I-746)+(1.049)+(6.001), (I-746)+(1.049)+(6.002), (I-746)+(1.049)+(6.003), (I-746)+(1.049)+(6.004), (I-746)+(1.049)+(7.001), (I-746)+(1.049)+(7.002), (I-746)+(1.049)+(7.003), (I-746)+(1.049)+(7.004), (I-746)+(1.049)+(7.005), (I-746)+(1.049)+(7.006), (I-746)+(1.049)+(9.001), (I-746)+(1.049)+(9.002), (I-746)+(1.049)+(9.003), (I-746)+(1.049)+(9.004), (I-746)+(1.049)+(9.005), (I-746)+(1.049)+(9.006), (I-746)+(1.049)+(9.007), (I-746)+(1.049)+(9.008), (I-746)+(1.049)+(9.009), (I-746)+(1.049)+(14.001), (I-746)+(1.049)+(14.002), (I-746)+(1.049)+(15.008), (I-746)+(1.049)+(15.011), (I-746)+(1.049)+(15.012), (I-746)+(1.049)+(15.016), (I-746)+(1.049)+(15.025), (I-746)+(1.049)+(15.027), (I-746)+(1.049)+(15.047), (I-746)+(1.049)+(15.063), (I-746)+(1.049)+(15.064), (I-746)+(1.049)+(16.001), (I-746)+(1.049)+(16.002), (I-746)+(1.049)+(16.003), (I-746)+(1.049)+(16.004), (I-746)+(1.049)+(16.005), (I-746)+(1.049)+(16.006), (I-746)+(1.049)+(16.007), (I-746)+(1.049)+(16.008), (I-746)+(1.049)+(17.001), (I-746)+(1.049)+(17.002), (I-746)+(1.049)+(17.003), (I-746)+(1.049)+(17.004), (I-746)+(1.049)+(17.005), (I-746)+(1.049)+(17.006), (I-746)+(1.049)+(17.007), (I-746)+(1.049)+(17.008), (I-746)+(1.049)+(17.009), (I-746)+(1.049)+(17.010), (I-746)+(1.049)+(17.011), (I-746)+(1.049)+(17.012), (I-746)+(1.049)+(18.001),

(I-746)+(1.050)+(1.051), (I-746)+(1.050)+(1.052), (I-746)+(1.050)+(1.053), (I-746)+(1.050)+(1.054), (I-746)+(1.050)+(1.055), (I-746)+(1.050)+(1.056), (I-746)+(1.050)+(1.057), (I-746)+(1.050)+(1.058), (I-746)+(1.050)+(1.059), (I-746)+(1.050)+(1.060), (I-746)+(1.050)+(1.061), (I-746)+(1.050)+(1.062), (I-746)+(1.050)+(1.063), (I-746)+(1.050)+(1.064), (I-746)+(1.050)+(1.065), (I-746)+(1.050)+(1.066), (I-746)+(1.050)+(1.067), (I-746)+(1.050)+(1.068), (I-746)+(1.050)+(1.069), (I-746)+(1.050)+(1.070), (I-746)+(1.050)+(1.071), (I-746)+(1.050)+(1.072), (I-746)+(1.050)+(1.073), (I-746)+(1.050)+(1.074), (I-746)+(1.050)+(1.075), (I-746)+(1.050)+(1.076), (I-746)+(1.050)+(1.077), (I-746)+(1.050)+(1.078), (I-746)+(1.050)+(1.079), (I-746)+(1.050)+(1.080), (I-746)+(1.050)+(1.081), (I-746)+(1.050)+(1.082), (I-746)+(1.050)+(1.083), (I-746)+(1.050)+(1.084), (I-746)+(1.050)+(1.085), (I-746)+(1.050)+(1.086), (I-746)+(1.050)+(1.087), (I-746)+(1.050)+(1.088), (I-746)+(1.050)+(1.089), (I-746)+(1.050)+(1.090), (I-746)+(1.050)+(1.091), (I-746)+(1.050)+(1.092), (I-746)+(1.050)+(2.001), (I-746)+(1.050)+(2.002), (I-746)+(1.050)+(2.003), (I-746)+(1.050)+(2.004), (I-746)+(1.050)+(2.005), (I-746)+(1.050)+(2.006), (I-746)+(1.050)+(2.007), (I-746)+(1.050)+(2.008), (I-746)+(1.050)+(2.009), (I-746)+(1.050)+(2.010), (I-746)+(1.050)+(2.011), (I-746)+(1.050)+(2.012), (I-746)+(1.050)+(2.013), (I-746)+(1.050)+(2.014), (I-746)+(1.050)+(2.015), (I-746)+(1.050)+(2.016), (I-746)+(1.050)+(2.017), (I-746)+(1.050)+(2.018), (I-746)+(1.050)+(2.019), (I-746)+(1.050)+(2.020), (I-746)+(1.050)+(2.021), (I-746)+(1.050)+(2.022), (I-746)+(1.050)+(2.023), (I-746)+(1.050)+(2.024), (I-746)+(1.050)+(2.025), (I-746)+(1.050)+(2.026), (I-746)+(1.050)+(2.027), (I-746)+(1.050)+(2.028), (I-746)+(1.050)+(2.029), (I-746)+(1.050)+(2.030), (I-746)+(1.050)+(2.031), (I-746)+(1.050)+(2.032), (I-746)+(1.050)+(2.033), (I-746)+(1.050)+(2.034), (I-746)+(1.050)+(2.035), (I-746)+(1.050)+(2.036), (I-746)+(1.050)+(2.037), (I-746)+(1.050)+(2.038), (I-746)+(1.050)+(2.039), (I-746)+(1.050)+(2.040), (I-746)+(1.050)+(2.041), (I-746)+(1.050)+(2.042), (I-746)+(1.050)+(2.043), (I-746)+(1.050)+(2.044), (I-746)+(1.050)+(2.045), (I-746)+(1.050)+(2.046), (I-746)+(1.050)+(2.047), (I-746)+(1.050)+(2.048), (I-746)+(1.050)+(2.049), (I-746)+(1.050)+(2.050), (I-746)+(1.050)+(2.051), (I-746)+(1.050)+(2.052), (I-746)+(1.050)+(2.053), (I-746)+(1.050)+(2.054), (I-746)+(1.050)+(2.055), (I-746)+(1.050)+(2.056), (I-746)+(1.050)+(2.057), (I-746)+(1.050)+(2.058), (I-746)+(1.050)+(2.059), (I-746)+(1.050)+(3.001), (I-746)+(1.050)+(3.002), (I-746)+(1.050)+(3.003), (I-746)+(1.050)+(3.004), (I-746)+(1.050)+(3.005), (I-746)+(1.050)+(3.006), (I-746)+(1.050)+(3.007), (I-746)+(1.050)+(3.008), (I-746)+(1.050)+(3.009), (I-746)+(1.050)+(3.010), (I-746)+(1.050)+(3.011), (I-746)+(1.050)+(3.012), (I-746)+(1.050)+(3.013), (I-746)+(1.050)+(3.014), (I-746)+(1.050)+(3.015), (I-746)+(1.050)+(3.016), (I-746)+(1.050)+(3.017), (I-746)+(1.050)+(3.018), (I-746)+(1.050)+(3.019), (I-746)+(1.050)+(3.020), (I-746)+(1.050)+(3.021), (I-746)+(1.050)+(3.022), (I-746)+(1.050)+(3.023), (I-746)+(1.050)+(3.024), (I-746)+(1.050)+(3.025), (I-746)+(1.050)+(3.026), (I-746)+(1.050)+(3.027), (I-746)+(1.050)+(3.028), (I-746)+(1.050)+(3.029), (I-746)+(1.050)+(3.030), (I-746)+(1.050)+(3.031), (I-746)+(1.050)+(5.001), (I-746)+(1.050)+(5.002), (I-746)+(1.050)+(5.003), (I-746)+(1.050)+(5.004), (I-746)+(1.050)+(5.005), (I-746)+(1.050)+(5.006), (I-746)+(1.050)+(5.007), (I-746)+(1.050)+(5.008), (I-746)+(1.050)+(5.009), (I-746)+(1.050)+(5.010), (I-746)+(1.050)+(5.011), (I-746)+(1.050)+(5.012), (I-746)+(1.050)+(5.013), (I-746)+(1.050)+(5.014), (I-746)+(1.050)+(5.015), (I-746)+(1.050)+(5.016), (I-746)+(1.050)+(5.017), (I-746)+(1.050)+(5.018), (I-746)+(1.050)+(5.019), (I-746)+(1.050)+(5.020), (I-746)+(1.050)+(5.021), (I-746)+(1.050)+(5.022), (I-746)+(1.050)+(5.023), (I-746)+(1.050)+(6.001), (I-746)+(1.050)+(6.002), (I-746)+(1.050)+(6.003), (I-746)+(1.050)+(6.004), (I-746)+(1.050)+(7.001), (I-746)+(1.050)+(7.002), (I-746)+(1.050)+(7.003), (I-746)+(1.050)+(7.004), (I-746)+(1.050)+(7.005), (I-746)+(1.050)+(7.006), (I-746)+(1.050)+(9.001), (I-746)+(1.050)+(9.002), (I-746)+(1.050)+(9.003), (I-746)+(1.050)+(9.004), (I-746)+(1.050)+(9.005), (I-746)+(1.050)+(9.006), (I-746)+(1.050)+(9.007), (I-746)+(1.050)+(9.008), (I-746)+(1.050)+(9.009), (I-746)+(1.050)+(14.001), (I-746)+(1.050)+(14.002), (I-746)+(1.050)+(15.008), (I-746)+(1.050)+(15.011), (I-746)+(1.050)+(15.012), (I-746)+(1.050)+(15.016), (I-746)+(1.050)+(15.025), (I-746)+(1.050)+(15.027), (I-746)+(1.050)+(15.047), (I-746)+(1.050)+(15.063), (I-746)+(1.050)+(15.064), (I-746)+(1.050)+(16.001), (I-746)+(1.050)+(16.002), (I-746)+(1.050)+(16.003), (I-746)+(1.050)+(16.004), (I-746)+(1.050)+(16.005), (I-746)+(1.050)+(16.006), (I-746)+(1.050)+(16.007), (I-746)+(1.050)+(16.008), (I-746)+(1.050)+(17.001), (I-746)+(1.050)+(17.002), (I-746)+(1.050)+(17.003), (I-746)+(1.050)+(17.004), (I-746)+(1.050)+(17.005), (I-746)+(1.050)+(17.006), (I-746)+(1.050)+(17.007), (I-746)+(1.050)+(17.008), (I-746)+(1.050)+(17.009), (I-746)+(1.050)+(17.010), (I-746)+(1.050)+(17.011), (I-746)+(1.050)+(17.012), (I-746)+(1.050)+(18.001),

(I-746)+(1.051)+(1.052), (I-746)+(1.051)+(1.053), (I-746)+(1.051)+(1.054), (I-746)+(1.051)+(1.055), (I-746)+(1.051)+(1.056), (I-746)+(1.051)+(1.057), (I-746)+(1.051)+(1.058), (I-746)+(1.051)+(1.059), (I-746)+(1.051)+(1.060), (I-746)+(1.051)+(1.061), (I-746)+(1.051)+(1.062), (I-746)+(1.051)+(1.063), (I-746)+(1.051)+(1.064), (I-746)+(1.051)+(1.065), (I-746)+(1.051)+(1.066), (I-746)+(1.051)+(1.067), (I-746)+(1.051)+(1.068), (I-746)+(1.051)+(1.069), (I-746)+(1.051)+(1.070), (I-746)+(1.051)+(1.071), (I-746)+(1.051)+(1.072), (I-746)+(1.051)+(1.073), (I-746)+(1.051)+(1.074), (I-746)+(1.051)+(1.075), (I-746)+(1.051)+(1.076), (I-746)+(1.051)+(1.077), (I-746)+(1.051)+(1.078), (I-746)+(1.051)+(1.079), (I-746)+(1.051)+(1.080), (I-746)+(1.051)+(1.081), (I-746)+(1.051)+(1.082), (I-746)+(1.051)+(1.083), (I-746)+(1.051)+(1.084), (I-746)+(1.051)+(1.085), (I-746)+(1.051)+(1.086), (I-746)+(1.051)+(1.087), (I-746)+(1.051)+(1.088), (I-746)+(1.051)+(1.089), (I-746)+(1.051)+(1.090), (I-746)+(1.051)+(1.091), (I-746)+(1.051)+(1.092), (I-746)+(1.051)+(2.001), (I-746)+(1.051)+(2.002), (I-746)+(1.051)+(2.003), (I-746)+(1.051)+(2.004), (I-746)+(1.051)+(2.005), (I-746)+(1.051)+(2.006), (I-746)+(1.051)+(2.007), (I-746)+(1.051)+(2.008), (I-746)+(1.051)+(2.009), (I-746)+(1.051)+(2.010), (I-746)+(1.051)+(2.011), (I-746)+(1.051)+(2.012), (I-746)+(1.051)+(2.013), (I-746)+(1.051)+(2.014), (I-746)+(1.051)+(2.015), (I-746)+(1.051)+(2.016), (I-746)+(1.051)+(2.017), (I-746)+(1.051)+(2.018), (I-746)+(1.051)+(2.019), (I-746)+(1.051)+(2.020), (I-746)+(1.051)+(2.021), (I-746)+(1.051)+(2.022), (I-746)+(1.051)+(2.023), (I-746)+(1.051)+(2.024), (I-746)+(1.051)+(2.025), (I-746)+(1.051)+(2.026), (I-746)+(1.051)+(2.027), (I-746)+(1.051)+(2.028), (I-746)+(1.051)+(2.029), (I-746)+(1.051)+(2.030), (I-746)+(1.051)+(2.031), (I-746)+(1.051)+(2.032), (I-746)+(1.051)+(2.033), (I-746)+(1.051)+(2.034), (I-746)+(1.051)+(2.035), (I-746)+(1.051)+(2.036), (I-746)+(1.051)+(2.037), (I-746)+(1.051)+(2.038), (I-746)+(1.051)+(2.039), (I-746)+(1.051)+(2.040), (I-746)+(1.051)+(2.041), (I-746)+(1.051)+(2.042), (I-746)+(1.051)+(2.043), (I-746)+(1.051)+(2.044), (I-746)+(1.051)+(2.045), (I-746)+(1.051)+(2.046), (I-746)+(1.051)+(2.047), (I-746)+(1.051)+(2.048), (I-746)+(1.051)+(2.049), (I-746)+(1.051)+(2.050), (I-746)+(1.051)+(2.051), (I-746)+(1.051)+(2.052), (I-746)+(1.051)+(2.053), (I-746)+(1.051)+(2.054), (I-746)+(1.051)+(2.055), (I-746)+(1.051)+(2.056), (I-746)+(1.051)+(2.057), (I-746)+(1.051)+(2.058), (I-746)+(1.051)+(2.059), (I-746)+(1.051)+(3.001), (I-746)+(1.051)+(3.002), (I-746)+(1.051)+(3.003), (I-746)+(1.051)+(3.004), (I-746)+(1.051)+(3.005), (I-746)+(1.051)+(3.006), (I-746)+(1.051)+(3.007), (I-746)+(1.051)+(3.008), (I-746)+(1.051)+(3.009), (I-746)+(1.051)+(3.010), (I-746)+(1.051)+(3.011), (I-746)+(1.051)+(3.012), (I-746)+(1.051)+(3.013), (I-746)+(1.051)+(3.014), (I-746)+(1.051)+(3.015), (I-746)+(1.051)+(3.016), (I-746)+(1.051)+(3.017), (I-746)+(1.051)+(3.018), (I-746)+(1.051)+(3.019), (I-746)+(1.051)+(3.020), (I-746)+(1.051)+(3.021), (I-746)+(1.051)+(3.022), (I-746)+(1.051)+(3.023), (I-746)+(1.051)+(3.024), (I-746)+(1.051)+(3.025), (I-746)+(1.051)+(3.026), (I-746)+(1.051)+(3.027), (I-746)+(1.051)+(3.028), (I-746)+(1.051)+(3.029), (I-746)+(1.051)+(3.030), (I-746)+(1.051)+(3.031), (I-746)+(1.051)+(5.001), (I-746)+(1.051)+(5.002), (I-746)+(1.051)+(5.003), (I-746)+(1.051)+(5.004), (I-746)+(1.051)+(5.005), (I-746)+(1.051)+(5.006), (I-746)+(1.051)+(5.007), (I-746)+(1.051)+(5.008), (I-746)+(1.051)+(5.009), (I-746)+(1.051)+(5.010), (I-746)+(1.051)+(5.011), (I-746)+(1.051)+(5.012), (I-746)+(1.051)+(5.013), (I-746)+(1.051)+(5.014), (I-746)+(1.051)+(5.015), (I-746)+(1.051)+(5.016), (I-746)+(1.051)+(5.017), (I-746)+(1.051)+(5.018), (I-746)+(1.051)+(5.019), (I-746)+(1.051)+(5.020), (I-746)+(1.051)+(5.021), (I-746)+(1.051)+(5.022), (I-746)+(1.051)+(5.023), (I-746)+(1.051)+(6.001), (I-746)+(1.051)+(6.002), (I-746)+(1.051)+(6.003), (I-746)+(1.051)+(6.004), (I-746)+(1.051)+(7.001), (I-746)+(1.051)+(7.002), (I-746)+(1.051)+(7.003), (I-746)+(1.051)+(7.004), (I-746)+(1.051)+(7.005), (I-746)+(1.051)+(7.006), (I-746)+(1.051)+(9.001), (I-746)+(1.051)+(9.002), (I-746)+(1.051)+(9.003), (I-746)+(1.051)+(9.004), (I-746)+(1.051)+(9.005), (I-746)+(1.051)+(9.006), (I-746)+(1.051)+(9.007), (I-746)+(1.051)+(9.008), (I-746)+(1.051)+(9.009), (I-746)+(1.051)+(14.001), (I-746)+(1.051)+(14.002), (I-746)+(1.051)+(15.008), (I-746)+(1.051)+(15.011), (I-746)+(1.051)+(15.012), (I-746)+(1.051)+(15.016), (I-746)+(1.051)+(15.025), (I-746)+(1.051)+(15.027), (I-746)+(1.051)+(15.047), (I-746)+(1.051)+(15.063), (I-746)+(1.051)+(15.064), (I-746)+(1.051)+(16.001), (I-746)+(1.051)+(16.002), (I-746)+(1.051)+(16.003), (I-746)+(1.051)+(16.004), (I-746)+(1.051)+(16.005), (I-746)+(1.051)+(16.006), (I-746)+(1.051)+(16.007), (I-746)+(1.051)+(16.008), (I-746)+(1.051)+(17.001), (I-746)+(1.051)+(17.002), (I-746)+(1.051)+(17.003), (I-746)+(1.051)+(17.004), (I-746)+(1.051)+(17.005), (I-746)+(1.051)+(17.006), (I-746)+(1.051)+(17.007), (I-746)+(1.051)+(17.008), (I-746)+(1.051)+(17.009), (I-746)+(1.051)+(17.010), (I-746)+(1.051)+(17.011), (I-746)+(1.051)+(17.012), (I-746)+(1.051)+(18.001),

(I-746)+(1.052)+(1.053), (I-746)+(1.052)+(1.054), (I-746)+(1.052)+(1.055), (I-746)+(1.052)+(1.056), (I-746)+(1.052)+(1.057), (I-746)+(1.052)+(1.058), (I-746)+(1.052)+(1.059), (I-746)+(1.052)+(1.060), (I-746)+(1.052)+(1.061), (I-746)+(1.052)+(1.062), (I-746)+(1.052)+(1.063), (I-746)+(1.052)+(1.064), (I-746)+(1.052)+(1.065), (I-746)+(1.052)+(1.066), (I-746)+(1.052)+(1.067), (I-746)+(1.052)+(1.068), (I-746)+(1.052)+(1.069), (I-746)+(1.052)+(1.070), (I-746)+(1.052)+(1.071), (I-746)+(1.052)+(1.072), (I-746)+(1.052)+(1.073), (I-746)+(1.052)+(1.074), (I-746)+(1.052)+(1.075), (I-746)+(1.052)+(1.076), (I-746)+(1.052)+(1.077), (I-746)+(1.052)+(1.078), (I-746)+(1.052)+(1.079), (I-746)+(1.052)+(1.080), (I-746)+(1.052)+(1.081), (I-746)+(1.052)+(1.082), (I-746)+(1.052)+(1.083), (I-746)+(1.052)+(1.084), (I-746)+(1.052)+(1.085), (I-746)+(1.052)+(1.086), (I-746)+(1.052)+(1.087), (I-746)+(1.052)+(1.088), (I-746)+(1.052)+(1.089), (I-746)+(1.052)+(1.090), (I-746)+(1.052)+(1.091), (I-746)+(1.052)+(1.092), (I-746)+(1.052)+(2.001), (I-746)+(1.052)+(2.002), (I-746)+(1.052)+(2.003), (I-746)+(1.052)+(2.004), (I-746)+(1.052)+(2.005), (I-746)+(1.052)+(2.006), (I-746)+(1.052)+(2.007), (I-746)+(1.052)+(2.008), (I-746)+(1.052)+(2.009), (I-746)+(1.052)+(2.010), (I-746)+(1.052)+(2.011), (I-746)+(1.052)+(2.012), (I-746)+(1.052)+(2.013), (I-746)+(1.052)+(2.014), (I-746)+(1.052)+(2.015), (I-746)+(1.052)+(2.016), (I-746)+(1.052)+(2.017), (I-746)+(1.052)+(2.018), (I-746)+(1.052)+(2.019), (I-746)+(1.052)+(2.020), (I-746)+(1.052)+(2.021), (I-746)+(1.052)+(2.022), (I-746)+(1.052)+(2.023), (I-746)+(1.052)+(2.024), (I-746)+(1.052)+(2.025), (I-746)+(1.052)+(2.026), (I-746)+(1.052)+(2.027), (I-746)+(1.052)+(2.028), (I-746)+(1.052)+(2.029), (I-746)+(1.052)+(2.030), (I-746)+(1.052)+(2.031), (I-746)+(1.052)+(2.032), (I-746)+(1.052)+(2.033), (I-746)+(1.052)+(2.034), (I-746)+(1.052)+(2.035), (I-746)+(1.052)+(2.036), (I-746)+(1.052)+(2.037), (I-746)+(1.052)+(2.038), (I-746)+(1.052)+(2.039), (I-746)+(1.052)+(2.040), (I-746)+(1.052)+(2.041), (I-746)+(1.052)+(2.042), (I-746)+(1.052)+(2.043), (I-746)+(1.052)+(2.044), (I-746)+(1.052)+(2.045), (I-746)+(1.052)+(2.046), (I-746)+(1.052)+(2.047), (I-746)+(1.052)+(2.048), (I-746)+(1.052)+(2.049), (I-746)+(1.052)+(2.050), (I-746)+(1.052)+(2.051), (I-746)+(1.052)+(2.052), (I-746)+(1.052)+(2.053), (I-746)+(1.052)+(2.054), (I-746)+(1.052)+(2.055), (I-746)+(1.052)+(2.056), (I-746)+(1.052)+(2.057), (I-746)+(1.052)+(2.058), (I-746)+(1.052)+(2.059), (I-746)+(1.052)+(3.001), (I-746)+(1.052)+(3.002), (I-746)+(1.052)+(3.003), (I-746)+(1.052)+(3.004), (I-746)+(1.052)+(3.005), (I-746)+(1.052)+(3.006), (I-746)+(1.052)+(3.007), (I-746)+(1.052)+(3.008), (I-746)+(1.052)+(3.009), (I-746)+(1.052)+(3.010), (I-746)+(1.052)+(3.011), (I-746)+(1.052)+(3.012), (I-746)+(1.052)+(3.013), (I-746)+(1.052)+(3.014), (I-746)+(1.052)+(3.015), (I-746)+(1.052)+(3.016), (I-746)+(1.052)+(3.017), (I-746)+(1.052)+(3.018), (I-746)+(1.052)+(3.019), (I-746)+(1.052)+(3.020), (I-746)+(1.052)+(3.021), (I-746)+(1.052)+(3.022), (I-746)+(1.052)+(3.023), (I-746)+(1.052)+(3.024), (I-746)+(1.052)+(3.025), (I-746)+(1.052)+(3.026), (I-746)+(1.052)+(3.027), (I-746)+(1.052)+(3.028), (I-746)+(1.052)+(3.029), (I-746)+(1.052)+(3.030), (I-746)+(1.052)+(3.031), (I-746)+(1.052)+(5.001), (I-746)+(1.052)+(5.002), (I-746)+(1.052)+(5.003), (I-746)+(1.052)+(5.004), (I-746)+(1.052)+(5.005), (I-746)+(1.052)+(5.006), (I-746)+(1.052)+(5.007), (I-746)+(1.052)+(5.008), (I-746)+(1.052)+(5.009), (I-746)+(1.052)+(5.010), (I-746)+(1.052)+(5.011), (I-746)+(1.052)+(5.012), (I-746)+(1.052)+(5.013), (I-746)+(1.052)+(5.014), (I-746)+(1.052)+(5.015), (I-746)+(1.052)+(5.016), (I-746)+(1.052)+(5.017), (I-746)+(1.052)+(5.018), (I-746)+(1.052)+(5.019), (I-746)+(1.052)+(5.020), (I-746)+(1.052)+(5.021), (I-746)+(1.052)+(5.022), (I-746)+(1.052)+(5.023), (I-746)+(1.052)+(6.001), (I-746)+(1.052)+(6.002), (I-746)+(1.052)+(6.003), (I-746)+(1.052)+(6.004), (I-746)+(1.052)+(7.001), (I-746)+(1.052)+(7.002), (I-746)+(1.052)+(7.003), (I-746)+(1.052)+(7.004), (I-746)+(1.052)+(7.005), (I-746)+(1.052)+(7.006), (I-746)+(1.052)+(9.001), (I-746)+(1.052)+(9.002), (I-746)+(1.052)+(9.003), (I-746)+(1.052)+(9.004), (I-746)+(1.052)+(9.005), (I-746)+(1.052)+(9.006), (I-746)+(1.052)+(9.007), (I-746)+(1.052)+(9.008), (I-746)+(1.052)+(9.009), (I-746)+(1.052)+(14.001), (I-746)+(1.052)+(14.002), (I-746)+(1.052)+(15.008), (I-746)+(1.052)+(15.011), (I-746)+(1.052)+(15.012), (I-746)+(1.052)+(15.016), (I-746)+(1.052)+(15.025), (I-746)+(1.052)+(15.027), (I-746)+(1.052)+(15.047), (I-746)+(1.052)+(15.063), (I-746)+(1.052)+(15.064), (I-746)+(1.052)+(16.001), (I-746)+(1.052)+(16.002), (I-746)+(1.052)+(16.003), (I-746)+(1.052)+(16.004), (I-746)+(1.052)+(16.005), (I-746)+(1.052)+(16.006), (I-746)+(1.052)+(16.007), (I-746)+(1.052)+(16.008), (I-746)+(1.052)+(17.001), (I-746)+(1.052)+(17.002), (I-746)+(1.052)+(17.003), (I-746)+(1.052)+(17.004), (I-746)+(1.052)+(17.005), (I-746)+(1.052)+(17.006), (I-746)+(1.052)+(17.007), (I-746)+(1.052)+(17.008), (I-746)+(1.052)+(17.009), (I-746)+(1.052)+(17.010), (I-746)+(1.052)+(17.011), (I-746)+(1.052)+(17.012), (I-746)+(1.052)+(18.001),

(I-746)+(1.053)+(1.054), (I-746)+(1.053)+(1.055), (I-746)+(1.053)+(1.056), (I-746)+(1.053)+(1.057), (I-746)+(1.053)+(1.058), (I-746)+(1.053)+(1.059), (I-746)+(1.053)+(1.060), (I-746)+(1.053)+(1.061), (I-746)+(1.053)+(1.062), (I-746)+(1.053)+(1.063), (I-746)+(1.053)+(1.064), (I-746)+(1.053)+(1.065), (I-746)+(1.053)+(1.066), (I-746)+(1.053)+(1.067), (I-746)+(1.053)+(1.068), (I-746)+(1.053)+(1.069), (I-746)+(1.053)+(1.070), (I-746)+(1.053)+(1.071), (I-746)+(1.053)+(1.072), (I-746)+(1.053)+(1.073), (I-746)+(1.053)+(1.074), (I-746)+(1.053)+(1.075), (I-746)+(1.053)+(1.076), (I-746)+(1.053)+(1.077), (I-746)+(1.053)+(1.078), (I-746)+(1.053)+(1.079), (I-746)+(1.053)+(1.080), (I-746)+(1.053)+(1.081), (I-746)+(1.053)+(1.082), (I-746)+(1.053)+(1.083), (I-746)+(1.053)+(1.084), (I-746)+(1.053)+(1.085), (I-746)+(1.053)+(1.086), (I-746)+(1.053)+(1.087), (I-746)+(1.053)+(1.088), (I-746)+(1.053)+(1.089), (I-746)+(1.053)+(1.090), (I-746)+(1.053)+(1.091), (I-746)+(1.053)+(1.092), (I-746)+(1.053)+(2.001), (I-746)+(1.053)+(2.002), (I-746)+(1.053)+(2.003), (I-746)+(1.053)+(2.004), (I-746)+(1.053)+(2.005), (I-746)+(1.053)+(2.006), (I-746)+(1.053)+(2.007), (I-746)+(1.053)+(2.008), (I-746)+(1.053)+(2.009), (I-746)+(1.053)+(2.010), (I-746)+(1.053)+(2.011), (I-746)+(1.053)+(2.012), (I-746)+(1.053)+(2.013), (I-746)+(1.053)+(2.014), (I-746)+(1.053)+(2.015), (I-746)+(1.053)+(2.016), (I-746)+(1.053)+(2.017), (I-746)+(1.053)+(2.018), (I-746)+(1.053)+(2.019), (I-746)+(1.053)+(2.020), (I-746)+(1.053)+(2.021), (I-746)+(1.053)+(2.022), (I-746)+(1.053)+(2.023), (I-746)+(1.053)+(2.024), (I-746)+(1.053)+(2.025), (I-746)+(1.053)+(2.026), (I-746)+(1.053)+(2.027), (I-746)+(1.053)+(2.028), (I-746)+(1.053)+(2.029), (I-746)+(1.053)+(2.030), (I-746)+(1.053)+(2.031), (I-746)+(1.053)+(2.032), (I-746)+(1.053)+(2.033), (I-746)+(1.053)+(2.034), (I-746)+(1.053)+(2.035), (I-746)+(1.053)+(2.036), (I-746)+(1.053)+(2.037), (I-746)+(1.053)+(2.038), (I-746)+(1.053)+(2.039), (I-746)+(1.053)+(2.040), (I-746)+(1.053)+(2.041), (I-746)+(1.053)+(2.042), (I-746)+(1.053)+(2.043), (I-746)+(1.053)+(2.044), (I-746)+(1.053)+(2.045), (I-746)+(1.053)+(2.046), (I-746)+(1.053)+(2.047), (I-746)+(1.053)+(2.048), (I-746)+(1.053)+(2.049), (I-746)+(1.053)+(2.050), (I-746)+(1.053)+(2.051), (I-746)+(1.053)+(2.052), (I-746)+(1.053)+(2.053), (I-746)+(1.053)+(2.054), (I-746)+(1.053)+(2.055), (I-746)+(1.053)+(2.056), (I-746)+(1.053)+(2.057), (I-746)+(1.053)+(2.058), (I-746)+(1.053)+(2.059), (I-746)+(1.053)+(3.001), (I-746)+(1.053)+(3.002), (I-746)+(1.053)+(3.003), (I-746)+(1.053)+(3.004), (I-746)+(1.053)+(3.005), (I-746)+(1.053)+(3.006), (I-746)+(1.053)+(3.007), (I-746)+(1.053)+(3.008), (I-746)+(1.053)+(3.009), (I-746)+(1.053)+(3.010), (I-746)+(1.053)+(3.011), (I-746)+(1.053)+(3.012), (I-746)+(1.053)+(3.013), (I-746)+(1.053)+(3.014), (I-746)+(1.053)+(3.015), (I-746)+(1.053)+(3.016), (I-746)+(1.053)+(3.017), (I-746)+(1.053)+(3.018), (I-746)+(1.053)+(3.019), (I-746)+(1.053)+(3.020), (I-746)+(1.053)+(3.021), (I-746)+(1.053)+(3.022), (I-746)+(1.053)+(3.023), (I-746)+(1.053)+(3.024), (I-746)+(1.053)+(3.025), (I-746)+(1.053)+(3.026), (I-746)+(1.053)+(3.027), (I-746)+(1.053)+(3.028), (I-746)+(1.053)+(3.029), (I-746)+(1.053)+(3.030), (I-746)+(1.053)+(3.031), (I-746)+(1.053)+(5.001), (I-746)+(1.053)+(5.002), (I-746)+(1.053)+(5.003), (I-746)+(1.053)+(5.004), (I-746)+(1.053)+(5.005), (I-746)+(1.053)+(5.006), (I-746)+(1.053)+(5.007), (I-746)+(1.053)+(5.008), (I-746)+(1.053)+(5.009), (I-746)+(1.053)+(5.010), (I-746)+(1.053)+(5.011), (I-746)+(1.053)+(5.012), (I-746)+(1.053)+(5.013), (I-746)+(1.053)+(5.014), (I-746)+(1.053)+(5.015), (I-746)+(1.053)+(5.016), (I-746)+(1.053)+(5.017), (I-746)+(1.053)+(5.018), (I-746)+(1.053)+(5.019), (I-746)+(1.053)+(5.020), (I-746)+(1.053)+(5.021), (I-746)+(1.053)+(5.022), (I-746)+(1.053)+(5.023), (I-746)+(1.053)+(6.001), (I-746)+(1.053)+(6.002), (I-746)+(1.053)+(6.003), (I-746)+(1.053)+(6.004), (I-746)+(1.053)+(7.001), (I-746)+(1.053)+(7.002), (I-746)+(1.053)+(7.003), (I-746)+(1.053)+(7.004), (I-746)+(1.053)+(7.005), (I-746)+(1.053)+(7.006), (I-746)+(1.053)+(9.001), (I-746)+(1.053)+(9.002), (I-746)+(1.053)+(9.003), (I-746)+(1.053)+(9.004), (I-746)+(1.053)+(9.005), (I-746)+(1.053)+(9.006), (I-746)+(1.053)+(9.007), (I-746)+(1.053)+(9.008), (I-746)+(1.053)+(9.009), (I-746)+(1.053)+(14.001), (I-746)+(1.053)+(14.002), (I-746)+(1.053)+(15.008), (I-746)+(1.053)+(15.011), (I-746)+(1.053)+(15.012), (I-746)+(1.053)+(15.016), (I-746)+(1.053)+(15.025), (I-746)+(1.053)+(15.027), (I-746)+(1.053)+(15.047), (I-746)+(1.053)+(15.063), (I-746)+(1.053)+(15.064), (I-746)+(1.053)+(16.001), (I-746)+(1.053)+(16.002), (I-746)+(1.053)+(16.003), (I-746)+(1.053)+(16.004), (I-746)+(1.053)+(16.005), (I-746)+(1.053)+(16.006), (I-746)+(1.053)+(16.007), (I-746)+(1.053)+(16.008), (I-746)+(1.053)+(17.001), (I-746)+(1.053)+(17.002), (I-746)+(1.053)+(17.003), (I-746)+(1.053)+(17.004), (I-746)+(1.053)+(17.005), (I-746)+(1.053)+(17.006), (I-746)+(1.053)+(17.007), (I-746)+(1.053)+(17.008), (I-746)+(1.053)+(17.009), (I-746)+(1.053)+(17.010), (I-746)+(1.053)+(17.011), (I-746)+(1.053)+(17.012), (I-746)+(1.053)+(18.001),

(I-746)+(1.054)+(1.055), (I-746)+(1.054)+(1.056), (I-746)+(1.054)+(1.057), (I-746)+(1.054)+(1.058), (I-746)+(1.054)+(1.059), (I-746)+(1.054)+(1.060), (I-746)+(1.054)+(1.061), (I-746)+(1.054)+(1.062), (I-746)+(1.054)+(1.063), (I-746)+(1.054)+(1.064), (I-746)+(1.054)+(1.065), (I-746)+(1.054)+(1.066), (I-746)+(1.054)+(1.067), (I-746)+(1.054)+(1.068), (I-746)+(1.054)+(1.069), (I-746)+(1.054)+(1.070), (I-746)+(1.054)+(1.071), (I-746)+(1.054)+(1.072), (I-746)+(1.054)+(1.073), (I-746)+(1.054)+(1.074), (I-746)+(1.054)+(1.075), (I-746)+(1.054)+(1.076), (I-746)+(1.054)+(1.077), (I-746)+(1.054)+(1.078), (I-746)+(1.054)+(1.079), (I-746)+(1.054)+(1.080), (I-746)+(1.054)+(1.081), (I-746)+(1.054)+(1.082), (I-746)+(1.054)+(1.083), (I-746)+(1.054)+(1.084), (I-746)+(1.054)+(1.085), (I-746)+(1.054)+(1.086), (I-746)+(1.054)+(1.087), (I-746)+(1.054)+(1.088), (I-746)+(1.054)+(1.089), (I-746)+(1.054)+(1.090), (I-746)+(1.054)+(1.091), (I-746)+(1.054)+(1.092), (I-746)+(1.054)+(2.001), (I-746)+(1.054)+(2.002), (I-746)+(1.054)+(2.003), (I-746)+(1.054)+(2.004), (I-746)+(1.054)+(2.005), (I-746)+(1.054)+(2.006), (I-746)+(1.054)+(2.007), (I-746)+(1.054)+(2.008), (I-746)+(1.054)+(2.009), (I-746)+(1.054)+(2.010), (I-746)+(1.054)+(2.011), (I-746)+(1.054)+(2.012), (I-746)+(1.054)+(2.013), (I-746)+(1.054)+(2.014), (I-746)+(1.054)+(2.015), (I-746)+(1.054)+(2.016), (I-746)+(1.054)+(2.017), (I-746)+(1.054)+(2.018), (I-746)+(1.054)+(2.019), (I-746)+(1.054)+(2.020), (I-746)+(1.054)+(2.021), (I-746)+(1.054)+(2.022), (I-746)+(1.054)+(2.023), (I-746)+(1.054)+(2.024), (I-746)+(1.054)+(2.025), (I-746)+(1.054)+(2.026), (I-746)+(1.054)+(2.027), (I-746)+(1.054)+(2.028), (I-746)+(1.054)+(2.029), (I-746)+(1.054)+(2.030), (I-746)+(1.054)+(2.031), (I-746)+(1.054)+(2.032), (I-746)+(1.054)+(2.033), (I-746)+(1.054)+(2.034), (I-746)+(1.054)+(2.035), (I-746)+(1.054)+(2.036), (I-746)+(1.054)+(2.037), (I-746)+(1.054)+(2.038), (I-746)+(1.054)+(2.039), (I-746)+(1.054)+(2.040), (I-746)+(1.054)+(2.041), (I-746)+(1.054)+(2.042), (I-746)+(1.054)+(2.043), (I-746)+(1.054)+(2.044), (I-746)+(1.054)+(2.045), (I-746)+(1.054)+(2.046), (I-746)+(1.054)+(2.047), (I-746)+(1.054)+(2.048), (I-746)+(1.054)+(2.049), (I-746)+(1.054)+(2.050), (I-746)+(1.054)+(2.051), (I-746)+(1.054)+(2.052), (I-746)+(1.054)+(2.053), (I-746)+(1.054)+(2.054), (I-746)+(1.054)+(2.055), (I-746)+(1.054)+(2.056), (I-746)+(1.054)+(2.057), (I-746)+(1.054)+(2.058), (I-746)+(1.054)+(2.059), (I-746)+(1.054)+(3.001), (I-746)+(1.054)+(3.002), (I-746)+(1.054)+(3.003), (I-746)+(1.054)+(3.004), (I-746)+(1.054)+(3.005), (I-746)+(1.054)+(3.006), (I-746)+(1.054)+(3.007), (I-746)+(1.054)+(3.008), (I-746)+(1.054)+(3.009), (I-746)+(1.054)+(3.010), (I-746)+(1.054)+(3.011), (I-746)+(1.054)+(3.012), (I-746)+(1.054)+(3.013), (I-746)+(1.054)+(3.014), (I-746)+(1.054)+(3.015), (I-746)+(1.054)+(3.016), (I-746)+(1.054)+(3.017), (I-746)+(1.054)+(3.018), (I-746)+(1.054)+(3.019), (I-746)+(1.054)+(3.020), (I-746)+(1.054)+(3.021), (I-746)+(1.054)+(3.022), (I-746)+(1.054)+(3.023), (I-746)+(1.054)+(3.024), (I-746)+(1.054)+(3.025), (I-746)+(1.054)+(3.026), (I-746)+(1.054)+(3.027), (I-746)+(1.054)+(3.028), (I-746)+(1.054)+(3.029), (I-746)+(1.054)+(3.030), (I-746)+(1.054)+(3.031), (I-746)+(1.054)+(5.001), (I-746)+(1.054)+(5.002), (I-746)+(1.054)+(5.003), (I-746)+(1.054)+(5.004), (I-746)+(1.054)+(5.005), (I-746)+(1.054)+(5.006), (I-746)+(1.054)+(5.007), (I-746)+(1.054)+(5.008), (I-746)+(1.054)+(5.009), (I-746)+(1.054)+(5.010), (I-746)+(1.054)+(5.011), (I-746)+(1.054)+(5.012), (I-746)+(1.054)+(5.013), (I-746)+(1.054)+(5.014), (I-746)+(1.054)+(5.015), (I-746)+(1.054)+(5.016), (I-746)+(1.054)+(5.017), (I-746)+(1.054)+(5.018), (I-746)+(1.054)+(5.019), (I-746)+(1.054)+(5.020), (I-746)+(1.054)+(5.021), (I-746)+(1.054)+(5.022), (I-746)+(1.054)+(5.023), (I-746)+(1.054)+(6.001), (I-746)+(1.054)+(6.002), (I-746)+(1.054)+(6.003), (I-746)+(1.054)+(6.004), (I-746)+(1.054)+(7.001), (I-746)+(1.054)+(7.002), (I-746)+(1.054)+(7.003), (I-746)+(1.054)+(7.004), (I-746)+(1.054)+(7.005), (I-746)+(1.054)+(7.006), (I-746)+(1.054)+(9.001), (I-746)+(1.054)+(9.002), (I-746)+(1.054)+(9.003), (I-746)+(1.054)+(9.004), (I-746)+(1.054)+(9.005), (I-746)+(1.054)+(9.006), (I-746)+(1.054)+(9.007), (I-746)+(1.054)+(9.008), (I-746)+(1.054)+(9.009), (I-746)+(1.054)+(14.001), (I-746)+(1.054)+(14.002), (I-746)+(1.054)+(15.008), (I-746)+(1.054)+(15.011), (I-746)+(1.054)+(15.012), (I-746)+(1.054)+(15.016), (I-746)+(1.054)+(15.025), (I-746)+(1.054)+(15.027), (I-746)+(1.054)+(15.047), (I-746)+(1.054)+(15.063), (I-746)+(1.054)+(15.064), (I-746)+(1.054)+(16.001), (I-746)+(1.054)+(16.002), (I-746)+(1.054)+(16.003), (I-746)+(1.054)+(16.004), (I-746)+(1.054)+(16.005), (I-746)+(1.054)+(16.006), (I-746)+(1.054)+(16.007), (I-746)+(1.054)+(16.008), (I-746)+(1.054)+(17.001), (I-746)+(1.054)+(17.002), (I-746)+(1.054)+(17.003), (I-746)+(1.054)+(17.004), (I-746)+(1.054)+(17.005), (I-746)+(1.054)+(17.006), (I-746)+(1.054)+(17.007), (I-746)+(1.054)+(17.008), (I-746)+(1.054)+(17.009), (I-746)+(1.054)+(17.010), (I-746)+(1.054)+(17.011), (I-746)+(1.054)+(17.012), (I-746)+(1.054)+(18.001),

(I-746)+(1.055)+(1.056), (I-746)+(1.055)+(1.057), (I-746)+(1.055)+(1.058), (I-746)+(1.055)+(1.059), (I-746)+(1.055)+(1.060), (I-746)+(1.055)+(1.061), (I-746)+(1.055)+(1.062), (I-746)+(1.055)+(1.063), (I-746)+(1.055)+(1.064), (I-746)+(1.055)+(1.065), (I-746)+(1.055)+(1.066), (I-746)+(1.055)+(1.067), (I-746)+(1.055)+(1.068), (I-746)+(1.055)+(1.069), (I-746)+(1.055)+(1.070), (I-746)+(1.055)+(1.071), (I-746)+(1.055)+(1.072), (I-746)+(1.055)+(1.073), (I-746)+(1.055)+(1.074), (I-746)+(1.055)+(1.075), (I-746)+(1.055)+(1.076), (I-746)+(1.055)+(1.077), (I-746)+(1.055)+(1.078), (I-746)+(1.055)+(1.079), (I-746)+(1.055)+(1.080), (I-746)+(1.055)+(1.081), (I-746)+(1.055)+(1.082), (I-746)+(1.055)+(1.083), (I-746)+(1.055)+(1.084), (I-746)+(1.055)+(1.085), (I-746)+(1.055)+(1.086), (I-746)+(1.055)+(1.087), (I-746)+(1.055)+(1.088), (I-746)+(1.055)+(1.089), (I-746)+(1.055)+(1.090), (I-746)+(1.055)+(1.091), (I-746)+(1.055)+(1.092), (I-746)+(1.055)+(2.001), (I-746)+(1.055)+(2.002), (I-746)+(1.055)+(2.003), (I-746)+(1.055)+(2.004), (I-746)+(1.055)+(2.005), (I-746)+(1.055)+(2.006), (I-746)+(1.055)+(2.007), (I-746)+(1.055)+(2.008), (I-746)+(1.055)+(2.009), (I-746)+(1.055)+(2.010), (I-746)+(1.055)+(2.011), (I-746)+(1.055)+(2.012), (I-746)+(1.055)+(2.013), (I-746)+(1.055)+(2.014), (I-746)+(1.055)+(2.015), (I-746)+(1.055)+(2.016), (I-746)+(1.055)+(2.017), (I-746)+(1.055)+(2.018), (I-746)+(1.055)+(2.019), (I-746)+(1.055)+(2.020), (I-746)+(1.055)+(2.021), (I-746)+(1.055)+(2.022), (I-746)+(1.055)+(2.023), (I-746)+(1.055)+(2.024), (I-746)+(1.055)+(2.025), (I-746)+(1.055)+(2.026), (I-746)+(1.055)+(2.027), (I-746)+(1.055)+(2.028), (I-746)+(1.055)+(2.029), (I-746)+(1.055)+(2.030), (I-746)+(1.055)+(2.031), (I-746)+(1.055)+(2.032), (I-746)+(1.055)+(2.033), (I-746)+(1.055)+(2.034), (I-746)+(1.055)+(2.035), (I-746)+(1.055)+(2.036), (I-746)+(1.055)+(2.037), (I-746)+(1.055)+(2.038), (I-746)+(1.055)+(2.039), (I-746)+(1.055)+(2.040), (I-746)+(1.055)+(2.041), (I-746)+(1.055)+(2.042), (I-746)+(1.055)+(2.043), (I-746)+(1.055)+(2.044), (I-746)+(1.055)+(2.045), (I-746)+(1.055)+(2.046), (I-746)+(1.055)+(2.047), (I-746)+(1.055)+(2.048), (I-746)+(1.055)+(2.049), (I-746)+(1.055)+(2.050), (I-746)+(1.055)+(2.051), (I-746)+(1.055)+(2.052), (I-746)+(1.055)+(2.053), (I-746)+(1.055)+(2.054), (I-746)+(1.055)+(2.055), (I-746)+(1.055)+(2.056), (I-746)+(1.055)+(2.057), (I-746)+(1.055)+(2.058), (I-746)+(1.055)+(2.059), (I-746)+(1.055)+(3.001), (I-746)+(1.055)+(3.002), (I-746)+(1.055)+(3.003), (I-746)+(1.055)+(3.004), (I-746)+(1.055)+(3.005), (I-746)+(1.055)+(3.006), (I-746)+(1.055)+(3.007), (I-746)+(1.055)+(3.008), (I-746)+(1.055)+(3.009), (I-746)+(1.055)+(3.010), (I-746)+(1.055)+(3.011), (I-746)+(1.055)+(3.012), (I-746)+(1.055)+(3.013), (I-746)+(1.055)+(3.014), (I-746)+(1.055)+(3.015), (I-746)+(1.055)+(3.016), (I-746)+(1.055)+(3.017), (I-746)+(1.055)+(3.018), (I-746)+(1.055)+(3.019), (I-746)+(1.055)+(3.020), (I-746)+(1.055)+(3.021), (I-746)+(1.055)+(3.022), (I-746)+(1.055)+(3.023), (I-746)+(1.055)+(3.024), (I-746)+(1.055)+(3.025), (I-746)+(1.055)+(3.026), (I-746)+(1.055)+(3.027), (I-746)+(1.055)+(3.028), (I-746)+(1.055)+(3.029), (I-746)+(1.055)+(3.030), (I-746)+(1.055)+(3.031), (I-746)+(1.055)+(5.001), (I-746)+(1.055)+(5.002), (I-746)+(1.055)+(5.003), (I-746)+(1.055)+(5.004), (I-746)+(1.055)+(5.005), (I-746)+(1.055)+(5.006), (I-746)+(1.055)+(5.007), (I-746)+(1.055)+(5.008), (I-746)+(1.055)+(5.009), (I-746)+(1.055)+(5.010), (I-746)+(1.055)+(5.011), (I-746)+(1.055)+(5.012), (I-746)+(1.055)+(5.013), (I-746)+(1.055)+(5.014), (I-746)+(1.055)+(5.015), (I-746)+(1.055)+(5.016), (I-746)+(1.055)+(5.017), (I-746)+(1.055)+(5.018), (I-746)+(1.055)+(5.019), (I-746)+(1.055)+(5.020), (I-746)+(1.055)+(5.021), (I-746)+(1.055)+(5.022), (I-746)+(1.055)+(5.023), (I-746)+(1.055)+(6.001), (I-746)+(1.055)+(6.002), (I-746)+(1.055)+(6.003), (I-746)+(1.055)+(6.004), (I-746)+(1.055)+(7.001), (I-746)+(1.055)+(7.002), (I-746)+(1.055)+(7.003), (I-746)+(1.055)+(7.004), (I-746)+(1.055)+(7.005), (I-746)+(1.055)+(7.006), (I-746)+(1.055)+(9.001), (I-746)+(1.055)+(9.002), (I-746)+(1.055)+(9.003), (I-746)+(1.055)+(9.004), (I-746)+(1.055)+(9.005), (I-746)+(1.055)+(9.006), (I-746)+(1.055)+(9.007), (I-746)+(1.055)+(9.008), (I-746)+(1.055)+(9.009), (I-746)+(1.055)+(14.001), (I-746)+(1.055)+(14.002), (I-746)+(1.055)+(15.008), (I-746)+(1.055)+(15.011), (I-746)+(1.055)+(15.012), (I-746)+(1.055)+(15.016), (I-746)+(1.055)+(15.025), (I-746)+(1.055)+(15.027), (I-746)+(1.055)+(15.047), (I-746)+(1.055)+(15.063), (I-746)+(1.055)+(15.064), (I-746)+(1.055)+(16.001), (I-746)+(1.055)+(16.002), (I-746)+(1.055)+(16.003), (I-746)+(1.055)+(16.004), (I-746)+(1.055)+(16.005), (I-746)+(1.055)+(16.006), (I-746)+(1.055)+(16.007), (I-746)+(1.055)+(16.008), (I-746)+(1.055)+(17.001), (I-746)+(1.055)+(17.002), (I-746)+(1.055)+(17.003), (I-746)+(1.055)+(17.004), (I-746)+(1.055)+(17.005), (I-746)+(1.055)+(17.006), (I-746)+(1.055)+(17.007), (I-746)+(1.055)+(17.008), (I-746)+(1.055)+(17.009), (I-746)+(1.055)+(17.010), (I-746)+(1.055)+(17.011), (I-746)+(1.055)+(17.012), (I-746)+(1.055)+(18.001),

(I-746)+(1.056)+(1.057), (I-746)+(1.056)+(1.058), (I-746)+(1.056)+(1.059), (I-746)+(1.056)+(1.060), (I-746)+(1.056)+(1.061), (I-746)+(1.056)+(1.062), (I-746)+(1.056)+(1.063), (I-746)+(1.056)+(1.064), (I-746)+(1.056)+(1.065), (I-746)+(1.056)+(1.066), (I-746)+(1.056)+(1.067), (I-746)+(1.056)+(1.068), (I-746)+(1.056)+(1.069), (I-746)+(1.056)+(1.070), (I-746)+(1.056)+(1.071), (I-746)+(1.056)+(1.072), (I-746)+(1.056)+(1.073), (I-746)+(1.056)+(1.074), (I-746)+(1.056)+(1.075), (I-746)+(1.056)+(1.076), (I-746)+(1.056)+(1.077), (I-746)+(1.056)+(1.078), (I-746)+(1.056)+(1.079), (I-746)+(1.056)+(1.080), (I-746)+(1.056)+(1.081), (I-746)+(1.056)+(1.082), (I-746)+(1.056)+(1.083), (I-746)+(1.056)+(1.084), (I-746)+(1.056)+(1.085), (I-746)+(1.056)+(1.086), (I-746)+(1.056)+(1.087), (I-746)+(1.056)+(1.088), (I-746)+(1.056)+(1.089), (I-746)+(1.056)+(1.090), (I-746)+(1.056)+(1.091), (I-746)+(1.056)+(1.092), (I-746)+(1.056)+(2.001), (I-746)+(1.056)+(2.002), (I-746)+(1.056)+(2.003), (I-746)+(1.056)+(2.004), (I-746)+(1.056)+(2.005), (I-746)+(1.056)+(2.006), (I-746)+(1.056)+(2.007), (I-746)+(1.056)+(2.008), (I-746)+(1.056)+(2.009), (I-746)+(1.056)+(2.010), (I-746)+(1.056)+(2.011), (I-746)+(1.056)+(2.012), (I-746)+(1.056)+(2.013), (I-746)+(1.056)+(2.014), (I-746)+(1.056)+(2.015), (I-746)+(1.056)+(2.016), (I-746)+(1.056)+(2.017), (I-746)+(1.056)+(2.018), (I-746)+(1.056)+(2.019), (I-746)+(1.056)+(2.020), (I-746)+(1.056)+(2.021), (I-746)+(1.056)+(2.022), (I-746)+(1.056)+(2.023), (I-746)+(1.056)+(2.024), (I-746)+(1.056)+(2.025), (I-746)+(1.056)+(2.026), (I-746)+(1.056)+(2.027), (I-746)+(1.056)+(2.028), (I-746)+(1.056)+(2.029), (I-746)+(1.056)+(2.030), (I-746)+(1.056)+(2.031), (I-746)+(1.056)+(2.032), (I-746)+(1.056)+(2.033), (I-746)+(1.056)+(2.034), (I-746)+(1.056)+(2.035), (I-746)+(1.056)+(2.036), (I-746)+(1.056)+(2.037), (I-746)+(1.056)+(2.038), (I-746)+(1.056)+(2.039), (I-746)+(1.056)+(2.040), (I-746)+(1.056)+(2.041), (I-746)+(1.056)+(2.042), (I-746)+(1.056)+(2.043), (I-746)+(1.056)+(2.044), (I-746)+(1.056)+(2.045), (I-746)+(1.056)+(2.046), (I-746)+(1.056)+(2.047), (I-746)+(1.056)+(2.048), (I-746)+(1.056)+(2.049), (I-746)+(1.056)+(2.050), (I-746)+(1.056)+(2.051), (I-746)+(1.056)+(2.052), (I-746)+(1.056)+(2.053), (I-746)+(1.056)+(2.054), (I-746)+(1.056)+(2.055), (I-746)+(1.056)+(2.056), (I-746)+(1.056)+(2.057), (I-746)+(1.056)+(2.058), (I-746)+(1.056)+(2.059), (I-746)+(1.056)+(3.001), (I-746)+(1.056)+(3.002), (I-746)+(1.056)+(3.003), (I-746)+(1.056)+(3.004), (I-746)+(1.056)+(3.005), (I-746)+(1.056)+(3.006), (I-746)+(1.056)+(3.007), (I-746)+(1.056)+(3.008), (I-746)+(1.056)+(3.009), (I-746)+(1.056)+(3.010), (I-746)+(1.056)+(3.011), (I-746)+(1.056)+(3.012), (I-746)+(1.056)+(3.013), (I-746)+(1.056)+(3.014), (I-746)+(1.056)+(3.015), (I-746)+(1.056)+(3.016), (I-746)+(1.056)+(3.017), (I-746)+(1.056)+(3.018), (I-746)+(1.056)+(3.019), (I-746)+(1.056)+(3.020), (I-746)+(1.056)+(3.021), (I-746)+(1.056)+(3.022), (I-746)+(1.056)+(3.023), (I-746)+(1.056)+(3.024), (I-746)+(1.056)+(3.025), (I-746)+(1.056)+(3.026), (I-746)+(1.056)+(3.027), (I-746)+(1.056)+(3.028), (I-746)+(1.056)+(3.029), (I-746)+(1.056)+(3.030), (I-746)+(1.056)+(3.031), (I-746)+(1.056)+(5.001), (I-746)+(1.056)+(5.002), (I-746)+(1.056)+(5.003), (I-746)+(1.056)+(5.004), (I-746)+(1.056)+(5.005), (I-746)+(1.056)+(5.006), (I-746)+(1.056)+(5.007), (I-746)+(1.056)+(5.008), (I-746)+(1.056)+(5.009), (I-746)+(1.056)+(5.010), (I-746)+(1.056)+(5.011), (I-746)+(1.056)+(5.012), (I-746)+(1.056)+(5.013), (I-746)+(1.056)+(5.014), (I-746)+(1.056)+(5.015), (I-746)+(1.056)+(5.016), (I-746)+(1.056)+(5.017), (I-746)+(1.056)+(5.018), (I-746)+(1.056)+(5.019), (I-746)+(1.056)+(5.020), (I-746)+(1.056)+(5.021), (I-746)+(1.056)+(5.022), (I-746)+(1.056)+(5.023), (I-746)+(1.056)+(6.001), (I-746)+(1.056)+(6.002), (I-746)+(1.056)+(6.003), (I-746)+(1.056)+(6.004), (I-746)+(1.056)+(7.001), (I-746)+(1.056)+(7.002), (I-746)+(1.056)+(7.003), (I-746)+(1.056)+(7.004), (I-746)+(1.056)+(7.005), (I-746)+(1.056)+(7.006), (I-746)+(1.056)+(9.001), (I-746)+(1.056)+(9.002), (I-746)+(1.056)+(9.003), (I-746)+(1.056)+(9.004), (I-746)+(1.056)+(9.005), (I-746)+(1.056)+(9.006), (I-746)+(1.056)+(9.007), (I-746)+(1.056)+(9.008), (I-746)+(1.056)+(9.009), (I-746)+(1.056)+(14.001), (I-746)+(1.056)+(14.002), (I-746)+(1.056)+(15.008), (I-746)+(1.056)+(15.011), (I-746)+(1.056)+(15.012), (I-746)+(1.056)+(15.016), (I-746)+(1.056)+(15.025), (I-746)+(1.056)+(15.027), (I-746)+(1.056)+(15.047), (I-746)+(1.056)+(15.063), (I-746)+(1.056)+(15.064), (I-746)+(1.056)+(16.001), (I-746)+(1.056)+(16.002), (I-746)+(1.056)+(16.003), (I-746)+(1.056)+(16.004), (I-746)+(1.056)+(16.005), (I-746)+(1.056)+(16.006), (I-746)+(1.056)+(16.007), (I-746)+(1.056)+(16.008), (I-746)+(1.056)+(17.001), (I-746)+(1.056)+(17.002), (I-746)+(1.056)+(17.003), (I-746)+(1.056)+(17.004), (I-746)+(1.056)+(17.005), (I-746)+(1.056)+(17.006), (I-746)+(1.056)+(17.007), (I-746)+(1.056)+(17.008), (I-746)+(1.056)+(17.009), (I-746)+(1.056)+(17.010), (I-746)+(1.056)+(17.011), (I-746)+(1.056)+(17.012), (I-746)+(1.056)+(18.001),

(I-746)+(1.057)+(1.058), (I-746)+(1.057)+(1.059), (I-746)+(1.057)+(1.060), (I-746)+(1.057)+(1.061), (I-746)+(1.057)+(1.062), (I-746)+(1.057)+(1.063), (I-746)+(1.057)+(1.064), (I-746)+(1.057)+(1.065), (I-746)+(1.057)+(1.066), (I-746)+(1.057)+(1.067), (I-746)+(1.057)+(1.068), (I-746)+(1.057)+(1.069), (I-746)+(1.057)+(1.070), (I-746)+(1.057)+(1.071), (I-746)+(1.057)+(1.072), (I-746)+(1.057)+(1.073), (I-746)+(1.057)+(1.074), (I-746)+(1.057)+(1.075), (I-746)+(1.057)+(1.076), (I-746)+(1.057)+(1.077), (I-746)+(1.057)+(1.078), (I-746)+(1.057)+(1.079), (I-746)+(1.057)+(1.080), (I-746)+(1.057)+(1.081), (I-746)+(1.057)+(1.082), (I-746)+(1.057)+(1.083), (I-746)+(1.057)+(1.084), (I-746)+(1.057)+(1.085), (I-746)+(1.057)+(1.086), (I-746)+(1.057)+(1.087), (I-746)+(1.057)+(1.088), (I-746)+(1.057)+(1.089), (I-746)+(1.057)+(1.090), (I-746)+(1.057)+(1.091), (I-746)+(1.057)+(1.092), (I-746)+(1.057)+(2.001), (I-746)+(1.057)+(2.002), (I-746)+(1.057)+(2.003), (I-746)+(1.057)+(2.004), (I-746)+(1.057)+(2.005), (I-746)+(1.057)+(2.006), (I-746)+(1.057)+(2.007), (I-746)+(1.057)+(2.008), (I-746)+(1.057)+(2.009), (I-746)+(1.057)+(2.010), (I-746)+(1.057)+(2.011), (I-746)+(1.057)+(2.012), (I-746)+(1.057)+(2.013), (I-746)+(1.057)+(2.014), (I-746)+(1.057)+(2.015), (I-746)+(1.057)+(2.016), (I-746)+(1.057)+(2.017), (I-746)+(1.057)+(2.018), (I-746)+(1.057)+(2.019), (I-746)+(1.057)+(2.020), (I-746)+(1.057)+(2.021), (I-746)+(1.057)+(2.022), (I-746)+(1.057)+(2.023), (I-746)+(1.057)+(2.024), (I-746)+(1.057)+(2.025), (I-746)+(1.057)+(2.026), (I-746)+(1.057)+(2.027), (I-746)+(1.057)+(2.028), (I-746)+(1.057)+(2.029), (I-746)+(1.057)+(2.030), (I-746)+(1.057)+(2.031), (I-746)+(1.057)+(2.032), (I-746)+(1.057)+(2.033), (I-746)+(1.057)+(2.034), (I-746)+(1.057)+(2.035), (I-746)+(1.057)+(2.036), (I-746)+(1.057)+(2.037), (I-746)+(1.057)+(2.038), (I-746)+(1.057)+(2.039), (I-746)+(1.057)+(2.040), (I-746)+(1.057)+(2.041), (I-746)+(1.057)+(2.042), (I-746)+(1.057)+(2.043), (I-746)+(1.057)+(2.044), (I-746)+(1.057)+(2.045), (I-746)+(1.057)+(2.046), (I-746)+(1.057)+(2.047), (I-746)+(1.057)+(2.048), (I-746)+(1.057)+(2.049), (I-746)+(1.057)+(2.050), (I-746)+(1.057)+(2.051), (I-746)+(1.057)+(2.052), (I-746)+(1.057)+(2.053), (I-746)+(1.057)+(2.054), (I-746)+(1.057)+(2.055), (I-746)+(1.057)+(2.056), (I-746)+(1.057)+(2.057), (I-746)+(1.057)+(2.058), (I-746)+(1.057)+(2.059), (I-746)+(1.057)+(3.001), (I-746)+(1.057)+(3.002), (I-746)+(1.057)+(3.003), (I-746)+(1.057)+(3.004), (I-746)+(1.057)+(3.005), (I-746)+(1.057)+(3.006), (I-746)+(1.057)+(3.007), (I-746)+(1.057)+(3.008), (I-746)+(1.057)+(3.009), (I-746)+(1.057)+(3.010), (I-746)+(1.057)+(3.011), (I-746)+(1.057)+(3.012), (I-746)+(1.057)+(3.013), (I-746)+(1.057)+(3.014), (I-746)+(1.057)+(3.015), (I-746)+(1.057)+(3.016), (I-746)+(1.057)+(3.017), (I-746)+(1.057)+(3.018), (I-746)+(1.057)+(3.019), (I-746)+(1.057)+(3.020), (I-746)+(1.057)+(3.021), (I-746)+(1.057)+(3.022), (I-746)+(1.057)+(3.023), (I-746)+(1.057)+(3.024), (I-746)+(1.057)+(3.025), (I-746)+(1.057)+(3.026), (I-746)+(1.057)+(3.027), (I-746)+(1.057)+(3.028), (I-746)+(1.057)+(3.029), (I-746)+(1.057)+(3.030), (I-746)+(1.057)+(3.031), (I-746)+(1.057)+(5.001), (I-746)+(1.057)+(5.002), (I-746)+(1.057)+(5.003), (I-746)+(1.057)+(5.004), (I-746)+(1.057)+(5.005), (I-746)+(1.057)+(5.006), (I-746)+(1.057)+(5.007), (I-746)+(1.057)+(5.008), (I-746)+(1.057)+(5.009), (I-746)+(1.057)+(5.010), (I-746)+(1.057)+(5.011), (I-746)+(1.057)+(5.012), (I-746)+(1.057)+(5.013), (I-746)+(1.057)+(5.014), (I-746)+(1.057)+(5.015), (I-746)+(1.057)+(5.016), (I-746)+(1.057)+(5.017), (I-746)+(1.057)+(5.018), (I-746)+(1.057)+(5.019), (I-746)+(1.057)+(5.020), (I-746)+(1.057)+(5.021), (I-746)+(1.057)+(5.022), (I-746)+(1.057)+(5.023), (I-746)+(1.057)+(6.001), (I-746)+(1.057)+(6.002), (I-746)+(1.057)+(6.003), (I-746)+(1.057)+(6.004), (I-746)+(1.057)+(7.001), (I-746)+(1.057)+(7.002), (I-746)+(1.057)+(7.003), (I-746)+(1.057)+(7.004), (I-746)+(1.057)+(7.005), (I-746)+(1.057)+(7.006), (I-746)+(1.057)+(9.001), (I-746)+(1.057)+(9.002), (I-746)+(1.057)+(9.003), (I-746)+(1.057)+(9.004), (I-746)+(1.057)+(9.005), (I-746)+(1.057)+(9.006), (I-746)+(1.057)+(9.007), (I-746)+(1.057)+(9.008), (I-746)+(1.057)+(9.009), (I-746)+(1.057)+(14.001), (I-746)+(1.057)+(14.002), (I-746)+(1.057)+(15.008), (I-746)+(1.057)+(15.011), (I-746)+(1.057)+(15.012), (I-746)+(1.057)+(15.016), (I-746)+(1.057)+(15.025), (I-746)+(1.057)+(15.027), (I-746)+(1.057)+(15.047), (I-746)+(1.057)+(15.063), (I-746)+(1.057)+(15.064), (I-746)+(1.057)+(16.001), (I-746)+(1.057)+(16.002), (I-746)+(1.057)+(16.003), (I-746)+(1.057)+(16.004), (I-746)+(1.057)+(16.005), (I-746)+(1.057)+(16.006), (I-746)+(1.057)+(16.007), (I-746)+(1.057)+(16.008), (I-746)+(1.057)+(17.001), (I-746)+(1.057)+(17.002), (I-746)+(1.057)+(17.003), (I-746)+(1.057)+(17.004), (I-746)+(1.057)+(17.005), (I-746)+(1.057)+(17.006), (I-746)+(1.057)+(17.007), (I-746)+(1.057)+(17.008), (I-746)+(1.057)+(17.009), (I-746)+(1.057)+(17.010), (I-746)+(1.057)+(17.011), (I-746)+(1.057)+(17.012), (I-746)+(1.057)+(18.001),

(I-746)+(1.058)+(1.059), (I-746)+(1.058)+(1.060), (I-746)+(1.058)+(1.061), (I-746)+(1.058)+(1.062), (I-746)+(1.058)+(1.063), (I-746)+(1.058)+(1.064), (I-746)+(1.058)+(1.065), (I-746)+(1.058)+(1.066), (I-746)+(1.058)+(1.067), (I-746)+(1.058)+(1.068), (I-746)+(1.058)+(1.069), (I-746)+(1.058)+(1.070), (I-746)+(1.058)+(1.071), (I-746)+(1.058)+(1.072), (I-746)+(1.058)+(1.073), (I-746)+(1.058)+(1.074), (I-746)+(1.058)+(1.075), (I-746)+(1.058)+(1.076), (I-746)+(1.058)+(1.077), (I-746)+(1.058)+(1.078), (I-746)+(1.058)+(1.079), (I-746)+(1.058)+(1.080), (I-746)+(1.058)+(1.081), (I-746)+(1.058)+(1.082), (I-746)+(1.058)+(1.083), (I-746)+(1.058)+(1.084), (I-746)+(1.058)+(1.085), (I-746)+(1.058)+(1.086), (I-746)+(1.058)+(1.087), (I-746)+(1.058)+(1.088), (I-746)+(1.058)+(1.089), (I-746)+(1.058)+(1.090), (I-746)+(1.058)+(1.091), (I-746)+(1.058)+(1.092), (I-746)+(1.058)+(2.001), (I-746)+(1.058)+(2.002), (I-746)+(1.058)+(2.003), (I-746)+(1.058)+(2.004), (I-746)+(1.058)+(2.005), (I-746)+(1.058)+(2.006), (I-746)+(1.058)+(2.007), (I-746)+(1.058)+(2.008), (I-746)+(1.058)+(2.009), (I-746)+(1.058)+(2.010), (I-746)+(1.058)+(2.011), (I-746)+(1.058)+(2.012), (I-746)+(1.058)+(2.013), (I-746)+(1.058)+(2.014), (I-746)+(1.058)+(2.015), (I-746)+(1.058)+(2.016), (I-746)+(1.058)+(2.017), (I-746)+(1.058)+(2.018), (I-746)+(1.058)+(2.019), (I-746)+(1.058)+(2.020), (I-746)+(1.058)+(2.021), (I-746)+(1.058)+(2.022), (I-746)+(1.058)+(2.023), (I-746)+(1.058)+(2.024), (I-746)+(1.058)+(2.025), (I-746)+(1.058)+(2.026), (I-746)+(1.058)+(2.027), (I-746)+(1.058)+(2.028), (I-746)+(1.058)+(2.029), (I-746)+(1.058)+(2.030), (I-746)+(1.058)+(2.031), (I-746)+(1.058)+(2.032), (I-746)+(1.058)+(2.033), (I-746)+(1.058)+(2.034), (I-746)+(1.058)+(2.035), (I-746)+(1.058)+(2.036), (I-746)+(1.058)+(2.037), (I-746)+(1.058)+(2.038), (I-746)+(1.058)+(2.039), (I-746)+(1.058)+(2.040), (I-746)+(1.058)+(2.041), (I-746)+(1.058)+(2.042), (I-746)+(1.058)+(2.043), (I-746)+(1.058)+(2.044), (I-746)+(1.058)+(2.045), (I-746)+(1.058)+(2.046), (I-746)+(1.058)+(2.047), (I-746)+(1.058)+(2.048), (I-746)+(1.058)+(2.049), (I-746)+(1.058)+(2.050), (I-746)+(1.058)+(2.051), (I-746)+(1.058)+(2.052), (I-746)+(1.058)+(2.053), (I-746)+(1.058)+(2.054), (I-746)+(1.058)+(2.055), (I-746)+(1.058)+(2.056), (I-746)+(1.058)+(2.057), (I-746)+(1.058)+(2.058), (I-746)+(1.058)+(2.059), (I-746)+(1.058)+(3.001), (I-746)+(1.058)+(3.002), (I-746)+(1.058)+(3.003), (I-746)+(1.058)+(3.004), (I-746)+(1.058)+(3.005), (I-746)+(1.058)+(3.006), (I-746)+(1.058)+(3.007), (I-746)+(1.058)+(3.008), (I-746)+(1.058)+(3.009), (I-746)+(1.058)+(3.010), (I-746)+(1.058)+(3.011), (I-746)+(1.058)+(3.012), (I-746)+(1.058)+(3.013), (I-746)+(1.058)+(3.014), (I-746)+(1.058)+(3.015), (I-746)+(1.058)+(3.016), (I-746)+(1.058)+(3.017), (I-746)+(1.058)+(3.018), (I-746)+(1.058)+(3.019), (I-746)+(1.058)+(3.020), (I-746)+(1.058)+(3.021), (I-746)+(1.058)+(3.022), (I-746)+(1.058)+(3.023), (I-746)+(1.058)+(3.024), (I-746)+(1.058)+(3.025), (I-746)+(1.058)+(3.026), (I-746)+(1.058)+(3.027), (I-746)+(1.058)+(3.028), (I-746)+(1.058)+(3.029), (I-746)+(1.058)+(3.030), (I-746)+(1.058)+(3.031), (I-746)+(1.058)+(5.001), (I-746)+(1.058)+(5.002), (I-746)+(1.058)+(5.003), (I-746)+(1.058)+(5.004), (I-746)+(1.058)+(5.005), (I-746)+(1.058)+(5.006), (I-746)+(1.058)+(5.007), (I-746)+(1.058)+(5.008), (I-746)+(1.058)+(5.009), (I-746)+(1.058)+(5.010), (I-746)+(1.058)+(5.011), (I-746)+(1.058)+(5.012), (I-746)+(1.058)+(5.013), (I-746)+(1.058)+(5.014), (I-746)+(1.058)+(5.015), (I-746)+(1.058)+(5.016), (I-746)+(1.058)+(5.017), (I-746)+(1.058)+(5.018), (I-746)+(1.058)+(5.019), (I-746)+(1.058)+(5.020), (I-746)+(1.058)+(5.021), (I-746)+(1.058)+(5.022), (I-746)+(1.058)+(5.023), (I-746)+(1.058)+(6.001), (I-746)+(1.058)+(6.002), (I-746)+(1.058)+(6.003), (I-746)+(1.058)+(6.004), (I-746)+(1.058)+(7.001), (I-746)+(1.058)+(7.002), (I-746)+(1.058)+(7.003), (I-746)+(1.058)+(7.004), (I-746)+(1.058)+(7.005), (I-746)+(1.058)+(7.006), (I-746)+(1.058)+(9.001), (I-746)+(1.058)+(9.002), (I-746)+(1.058)+(9.003), (I-746)+(1.058)+(9.004), (I-746)+(1.058)+(9.005), (I-746)+(1.058)+(9.006), (I-746)+(1.058)+(9.007), (I-746)+(1.058)+(9.008), (I-746)+(1.058)+(9.009), (I-746)+(1.058)+(14.001), (I-746)+(1.058)+(14.002), (I-746)+(1.058)+(15.008), (I-746)+(1.058)+(15.011), (I-746)+(1.058)+(15.012), (I-746)+(1.058)+(15.016), (I-746)+(1.058)+(15.025), (I-746)+(1.058)+(15.027), (I-746)+(1.058)+(15.047), (I-746)+(1.058)+(15.063), (I-746)+(1.058)+(15.064), (I-746)+(1.058)+(16.001), (I-746)+(1.058)+(16.002), (I-746)+(1.058)+(16.003), (I-746)+(1.058)+(16.004), (I-746)+(1.058)+(16.005), (I-746)+(1.058)+(16.006), (I-746)+(1.058)+(16.007), (I-746)+(1.058)+(16.008), (I-746)+(1.058)+(17.001), (I-746)+(1.058)+(17.002), (I-746)+(1.058)+(17.003), (I-746)+(1.058)+(17.004), (I-746)+(1.058)+(17.005), (I-746)+(1.058)+(17.006), (I-746)+(1.058)+(17.007), (I-746)+(1.058)+(17.008), (I-746)+(1.058)+(17.009), (I-746)+(1.058)+(17.010), (I-746)+(1.058)+(17.011), (I-746)+(1.058)+(17.012), (I-746)+(1.058)+(18.001),

(I-746)+(1.059)+(1.060), (I-746)+(1.059)+(1.061), (I-746)+(1.059)+(1.062), (I-746)+(1.059)+(1.063), (I-746)+(1.059)+(1.064), (I-746)+(1.059)+(1.065), (I-746)+(1.059)+(1.066), (I-746)+(1.059)+(1.067), (I-746)+(1.059)+(1.068), (I-746)+(1.059)+(1.069), (I-746)+(1.059)+(1.070), (I-746)+(1.059)+(1.071), (I-746)+(1.059)+(1.072), (I-746)+(1.059)+(1.073), (I-746)+(1.059)+(1.074), (I-746)+(1.059)+(1.075), (I-746)+(1.059)+(1.076), (I-746)+(1.059)+(1.077), (I-746)+(1.059)+(1.078), (I-746)+(1.059)+(1.079), (I-746)+(1.059)+(1.080), (I-746)+(1.059)+(1.081), (I-746)+(1.059)+(1.082), (I-746)+(1.059)+(1.083), (I-746)+(1.059)+(1.084), (I-746)+(1.059)+(1.085), (I-746)+(1.059)+(1.086), (I-746)+(1.059)+(1.087), (I-746)+(1.059)+(1.088), (I-746)+(1.059)+(1.089), (I-746)+(1.059)+(1.090), (I-746)+(1.059)+(1.091), (I-746)+(1.059)+(1.092), (I-746)+(1.059)+(2.001), (I-746)+(1.059)+(2.002), (I-746)+(1.059)+(2.003), (I-746)+(1.059)+(2.004), (I-746)+(1.059)+(2.005), (I-746)+(1.059)+(2.006), (I-746)+(1.059)+(2.007), (I-746)+(1.059)+(2.008), (I-746)+(1.059)+(2.009), (I-746)+(1.059)+(2.010), (I-746)+(1.059)+(2.011), (I-746)+(1.059)+(2.012), (I-746)+(1.059)+(2.013), (I-746)+(1.059)+(2.014), (I-746)+(1.059)+(2.015), (I-746)+(1.059)+(2.016), (I-746)+(1.059)+(2.017), (I-746)+(1.059)+(2.018), (I-746)+(1.059)+(2.019), (I-746)+(1.059)+(2.020), (I-746)+(1.059)+(2.021), (I-746)+(1.059)+(2.022), (I-746)+(1.059)+(2.023), (I-746)+(1.059)+(2.024), (I-746)+(1.059)+(2.025), (I-746)+(1.059)+(2.026), (I-746)+(1.059)+(2.027), (I-746)+(1.059)+(2.028), (I-746)+(1.059)+(2.029), (I-746)+(1.059)+(2.030), (I-746)+(1.059)+(2.031), (I-746)+(1.059)+(2.032), (I-746)+(1.059)+(2.033), (I-746)+(1.059)+(2.034), (I-746)+(1.059)+(2.035), (I-746)+(1.059)+(2.036), (I-746)+(1.059)+(2.037), (I-746)+(1.059)+(2.038), (I-746)+(1.059)+(2.039), (I-746)+(1.059)+(2.040), (I-746)+(1.059)+(2.041), (I-746)+(1.059)+(2.042), (I-746)+(1.059)+(2.043), (I-746)+(1.059)+(2.044), (I-746)+(1.059)+(2.045), (I-746)+(1.059)+(2.046), (I-746)+(1.059)+(2.047), (I-746)+(1.059)+(2.048), (I-746)+(1.059)+(2.049), (I-746)+(1.059)+(2.050), (I-746)+(1.059)+(2.051), (I-746)+(1.059)+(2.052), (I-746)+(1.059)+(2.053), (I-746)+(1.059)+(2.054), (I-746)+(1.059)+(2.055), (I-746)+(1.059)+(2.056), (I-746)+(1.059)+(2.057), (I-746)+(1.059)+(2.058), (I-746)+(1.059)+(2.059), (I-746)+(1.059)+(3.001), (I-746)+(1.059)+(3.002), (I-746)+(1.059)+(3.003), (I-746)+(1.059)+(3.004), (I-746)+(1.059)+(3.005), (I-746)+(1.059)+(3.006), (I-746)+(1.059)+(3.007), (I-746)+(1.059)+(3.008), (I-746)+(1.059)+(3.009), (I-746)+(1.059)+(3.010), (I-746)+(1.059)+(3.011), (I-746)+(1.059)+(3.012), (I-746)+(1.059)+(3.013), (I-746)+(1.059)+(3.014), (I-746)+(1.059)+(3.015), (I-746)+(1.059)+(3.016), (I-746)+(1.059)+(3.017), (I-746)+(1.059)+(3.018), (I-746)+(1.059)+(3.019), (I-746)+(1.059)+(3.020), (I-746)+(1.059)+(3.021), (I-746)+(1.059)+(3.022), (I-746)+(1.059)+(3.023), (I-746)+(1.059)+(3.024), (I-746)+(1.059)+(3.025), (I-746)+(1.059)+(3.026), (I-746)+(1.059)+(3.027), (I-746)+(1.059)+(3.028), (I-746)+(1.059)+(3.029), (I-746)+(1.059)+(3.030), (I-746)+(1.059)+(3.031), (I-746)+(1.059)+(5.001), (I-746)+(1.059)+(5.002), (I-746)+(1.059)+(5.003), (I-746)+(1.059)+(5.004), (I-746)+(1.059)+(5.005), (I-746)+(1.059)+(5.006), (I-746)+(1.059)+(5.007), (I-746)+(1.059)+(5.008), (I-746)+(1.059)+(5.009), (I-746)+(1.059)+(5.010), (I-746)+(1.059)+(5.011), (I-746)+(1.059)+(5.012), (I-746)+(1.059)+(5.013), (I-746)+(1.059)+(5.014), (I-746)+(1.059)+(5.015), (I-746)+(1.059)+(5.016), (I-746)+(1.059)+(5.017), (I-746)+(1.059)+(5.018), (I-746)+(1.059)+(5.019), (I-746)+(1.059)+(5.020), (I-746)+(1.059)+(5.021), (I-746)+(1.059)+(5.022), (I-746)+(1.059)+(5.023), (I-746)+(1.059)+(6.001), (I-746)+(1.059)+(6.002), (I-746)+(1.059)+(6.003), (I-746)+(1.059)+(6.004), (I-746)+(1.059)+(7.001), (I-746)+(1.059)+(7.002), (I-746)+(1.059)+(7.003), (I-746)+(1.059)+(7.004), (I-746)+(1.059)+(7.005), (I-746)+(1.059)+(7.006), (I-746)+(1.059)+(9.001), (I-746)+(1.059)+(9.002), (I-746)+(1.059)+(9.003), (I-746)+(1.059)+(9.004), (I-746)+(1.059)+(9.005), (I-746)+(1.059)+(9.006), (I-746)+(1.059)+(9.007), (I-746)+(1.059)+(9.008), (I-746)+(1.059)+(9.009), (I-746)+(1.059)+(14.001), (I-746)+(1.059)+(14.002), (I-746)+(1.059)+(15.008), (I-746)+(1.059)+(15.011), (I-746)+(1.059)+(15.012), (I-746)+(1.059)+(15.016), (I-746)+(1.059)+(15.025), (I-746)+(1.059)+(15.027), (I-746)+(1.059)+(15.047), (I-746)+(1.059)+(15.063), (I-746)+(1.059)+(15.064), (I-746)+(1.059)+(16.001), (I-746)+(1.059)+(16.002), (I-746)+(1.059)+(16.003), (I-746)+(1.059)+(16.004), (I-746)+(1.059)+(16.005), (I-746)+(1.059)+(16.006), (I-746)+(1.059)+(16.007), (I-746)+(1.059)+(16.008), (I-746)+(1.059)+(17.001), (I-746)+(1.059)+(17.002), (I-746)+(1.059)+(17.003), (I-746)+(1.059)+(17.004), (I-746)+(1.059)+(17.005), (I-746)+(1.059)+(17.006), (I-746)+(1.059)+(17.007), (I-746)+(1.059)+(17.008), (I-746)+(1.059)+(17.009), (I-746)+(1.059)+(17.010), (I-746)+(1.059)+(17.011), (I-746)+(1.059)+(17.012), (I-746)+(1.059)+(18.001),

(I-746)+(1.060)+(1.061), (I-746)+(1.060)+(1.062), (I-746)+(1.060)+(1.063), (I-746)+(1.060)+(1.064), (I-746)+(1.060)+(1.065), (I-746)+(1.060)+(1.066), (I-746)+(1.060)+(1.067), (I-746)+(1.060)+(1.068), (I-746)+(1.060)+(1.069), (I-746)+(1.060)+(1.070), (I-746)+(1.060)+(1.071), (I-746)+(1.060)+(1.072), (I-746)+(1.060)+(1.073), (I-746)+(1.060)+(1.074), (I-746)+(1.060)+(1.075), (I-746)+(1.060)+(1.076), (I-746)+(1.060)+(1.077), (I-746)+(1.060)+(1.078), (I-746)+(1.060)+(1.079), (I-746)+(1.060)+(1.080), (I-746)+(1.060)+(1.081), (I-746)+(1.060)+(1.082), (I-746)+(1.060)+(1.083), (I-746)+(1.060)+(1.084), (I-746)+(1.060)+(1.085), (I-746)+(1.060)+(1.086), (I-746)+(1.060)+(1.087), (I-746)+(1.060)+(1.088), (I-746)+(1.060)+(1.089), (I-746)+(1.060)+(1.090), (I-746)+(1.060)+(1.091), (I-746)+(1.060)+(1.092), (I-746)+(1.060)+(2.001), (I-746)+(1.060)+(2.002), (I-746)+(1.060)+(2.003), (I-746)+(1.060)+(2.004), (I-746)+(1.060)+(2.005), (I-746)+(1.060)+(2.006), (I-746)+(1.060)+(2.007), (I-746)+(1.060)+(2.008), (I-746)+(1.060)+(2.009), (I-746)+(1.060)+(2.010), (I-746)+(1.060)+(2.011), (I-746)+(1.060)+(2.012), (I-746)+(1.060)+(2.013), (I-746)+(1.060)+(2.014), (I-746)+(1.060)+(2.015), (I-746)+(1.060)+(2.016), (I-746)+(1.060)+(2.017), (I-746)+(1.060)+(2.018), (I-746)+(1.060)+(2.019), (I-746)+(1.060)+(2.020), (I-746)+(1.060)+(2.021), (I-746)+(1.060)+(2.022), (I-746)+(1.060)+(2.023), (I-746)+(1.060)+(2.024), (I-746)+(1.060)+(2.025), (I-746)+(1.060)+(2.026), (I-746)+(1.060)+(2.027), (I-746)+(1.060)+(2.028), (I-746)+(1.060)+(2.029), (I-746)+(1.060)+(2.030), (I-746)+(1.060)+(2.031), (I-746)+(1.060)+(2.032), (I-746)+(1.060)+(2.033), (I-746)+(1.060)+(2.034), (I-746)+(1.060)+(2.035), (I-746)+(1.060)+(2.036), (I-746)+(1.060)+(2.037), (I-746)+(1.060)+(2.038), (I-746)+(1.060)+(2.039), (I-746)+(1.060)+(2.040), (I-746)+(1.060)+(2.041), (I-746)+(1.060)+(2.042), (I-746)+(1.060)+(2.043), (I-746)+(1.060)+(2.044), (I-746)+(1.060)+(2.045), (I-746)+(1.060)+(2.046), (I-746)+(1.060)+(2.047), (I-746)+(1.060)+(2.048), (I-746)+(1.060)+(2.049), (I-746)+(1.060)+(2.050), (I-746)+(1.060)+(2.051), (I-746)+(1.060)+(2.052), (I-746)+(1.060)+(2.053), (I-746)+(1.060)+(2.054), (I-746)+(1.060)+(2.055), (I-746)+(1.060)+(2.056), (I-746)+(1.060)+(2.057), (I-746)+(1.060)+(2.058), (I-746)+(1.060)+(2.059), (I-746)+(1.060)+(3.001), (I-746)+(1.060)+(3.002), (I-746)+(1.060)+(3.003), (I-746)+(1.060)+(3.004), (I-746)+(1.060)+(3.005), (I-746)+(1.060)+(3.006), (I-746)+(1.060)+(3.007), (I-746)+(1.060)+(3.008), (I-746)+(1.060)+(3.009), (I-746)+(1.060)+(3.010), (I-746)+(1.060)+(3.011), (I-746)+(1.060)+(3.012), (I-746)+(1.060)+(3.013), (I-746)+(1.060)+(3.014), (I-746)+(1.060)+(3.015), (I-746)+(1.060)+(3.016), (I-746)+(1.060)+(3.017), (I-746)+(1.060)+(3.018), (I-746)+(1.060)+(3.019), (I-746)+(1.060)+(3.020), (I-746)+(1.060)+(3.021), (I-746)+(1.060)+(3.022), (I-746)+(1.060)+(3.023), (I-746)+(1.060)+(3.024), (I-746)+(1.060)+(3.025), (I-746)+(1.060)+(3.026), (I-746)+(1.060)+(3.027), (I-746)+(1.060)+(3.028), (I-746)+(1.060)+(3.029), (I-746)+(1.060)+(3.030), (I-746)+(1.060)+(3.031), (I-746)+(1.060)+(5.001), (I-746)+(1.060)+(5.002), (I-746)+(1.060)+(5.003), (I-746)+(1.060)+(5.004), (I-746)+(1.060)+(5.005), (I-746)+(1.060)+(5.006), (I-746)+(1.060)+(5.007), (I-746)+(1.060)+(5.008), (I-746)+(1.060)+(5.009), (I-746)+(1.060)+(5.010), (I-746)+(1.060)+(5.011), (I-746)+(1.060)+(5.012), (I-746)+(1.060)+(5.013), (I-746)+(1.060)+(5.014), (I-746)+(1.060)+(5.015), (I-746)+(1.060)+(5.016), (I-746)+(1.060)+(5.017), (I-746)+(1.060)+(5.018), (I-746)+(1.060)+(5.019), (I-746)+(1.060)+(5.020), (I-746)+(1.060)+(5.021), (I-746)+(1.060)+(5.022), (I-746)+(1.060)+(5.023), (I-746)+(1.060)+(6.001), (I-746)+(1.060)+(6.002), (I-746)+(1.060)+(6.003), (I-746)+(1.060)+(6.004), (I-746)+(1.060)+(7.001), (I-746)+(1.060)+(7.002), (I-746)+(1.060)+(7.003), (I-746)+(1.060)+(7.004), (I-746)+(1.060)+(7.005), (I-746)+(1.060)+(7.006), (I-746)+(1.060)+(9.001), (I-746)+(1.060)+(9.002), (I-746)+(1.060)+(9.003), (I-746)+(1.060)+(9.004), (I-746)+(1.060)+(9.005), (I-746)+(1.060)+(9.006), (I-746)+(1.060)+(9.007), (I-746)+(1.060)+(9.008), (I-746)+(1.060)+(9.009), (I-746)+(1.060)+(14.001), (I-746)+(1.060)+(14.002), (I-746)+(1.060)+(15.008), (I-746)+(1.060)+(15.011), (I-746)+(1.060)+(15.012), (I-746)+(1.060)+(15.016), (I-746)+(1.060)+(15.025), (I-746)+(1.060)+(15.027), (I-746)+(1.060)+(15.047), (I-746)+(1.060)+(15.063), (I-746)+(1.060)+(15.064), (I-746)+(1.060)+(16.001), (I-746)+(1.060)+(16.002), (I-746)+(1.060)+(16.003), (I-746)+(1.060)+(16.004), (I-746)+(1.060)+(16.005), (I-746)+(1.060)+(16.006), (I-746)+(1.060)+(16.007), (I-746)+(1.060)+(16.008), (I-746)+(1.060)+(17.001), (I-746)+(1.060)+(17.002), (I-746)+(1.060)+(17.003), (I-746)+(1.060)+(17.004), (I-746)+(1.060)+(17.005), (I-746)+(1.060)+(17.006), (I-746)+(1.060)+(17.007), (I-746)+(1.060)+(17.008), (I-746)+(1.060)+(17.009), (I-746)+(1.060)+(17.010), (I-746)+(1.060)+(17.011), (I-746)+(1.060)+(17.012), (I-746)+(1.060)+(18.001),

(I-746)+(1.061)+(1.062), (I-746)+(1.061)+(1.063), (I-746)+(1.061)+(1.064), (I-746)+(1.061)+(1.065), (I-746)+(1.061)+(1.066), (I-746)+(1.061)+(1.067), (I-746)+(1.061)+(1.068), (I-746)+(1.061)+(1.069), (I-746)+(1.061)+(1.070), (I-746)+(1.061)+(1.071), (I-746)+(1.061)+(1.072), (I-746)+(1.061)+(1.073), (I-746)+(1.061)+(1.074), (I-746)+(1.061)+(1.075), (I-746)+(1.061)+(1.076), (I-746)+(1.061)+(1.077), (I-746)+(1.061)+(1.078), (I-746)+(1.061)+(1.079), (I-746)+(1.061)+(1.080), (I-746)+(1.061)+(1.081), (I-746)+(1.061)+(1.082), (I-746)+(1.061)+(1.083), (I-746)+(1.061)+(1.084), (I-746)+(1.061)+(1.085), (I-746)+(1.061)+(1.086), (I-746)+(1.061)+(1.087), (I-746)+(1.061)+(1.088), (I-746)+(1.061)+(1.089), (I-746)+(1.061)+(1.090), (I-746)+(1.061)+(1.091), (I-746)+(1.061)+(1.092), (I-746)+(1.061)+(2.001), (I-746)+(1.061)+(2.002), (I-746)+(1.061)+(2.003), (I-746)+(1.061)+(2.004), (I-746)+(1.061)+(2.005), (I-746)+(1.061)+(2.006), (I-746)+(1.061)+(2.007), (I-746)+(1.061)+(2.008), (I-746)+(1.061)+(2.009), (I-746)+(1.061)+(2.010), (I-746)+(1.061)+(2.011), (I-746)+(1.061)+(2.012), (I-746)+(1.061)+(2.013), (I-746)+(1.061)+(2.014), (I-746)+(1.061)+(2.015), (I-746)+(1.061)+(2.016), (I-746)+(1.061)+(2.017), (I-746)+(1.061)+(2.018), (I-746)+(1.061)+(2.019), (I-746)+(1.061)+(2.020), (I-746)+(1.061)+(2.021), (I-746)+(1.061)+(2.022), (I-746)+(1.061)+(2.023), (I-746)+(1.061)+(2.024), (I-746)+(1.061)+(2.025), (I-746)+(1.061)+(2.026), (I-746)+(1.061)+(2.027), (I-746)+(1.061)+(2.028), (I-746)+(1.061)+(2.029), (I-746)+(1.061)+(2.030), (I-746)+(1.061)+(2.031), (I-746)+(1.061)+(2.032), (I-746)+(1.061)+(2.033), (I-746)+(1.061)+(2.034), (I-746)+(1.061)+(2.035), (I-746)+(1.061)+(2.036), (I-746)+(1.061)+(2.037), (I-746)+(1.061)+(2.038), (I-746)+(1.061)+(2.039), (I-746)+(1.061)+(2.040), (I-746)+(1.061)+(2.041), (I-746)+(1.061)+(2.042), (I-746)+(1.061)+(2.043), (I-746)+(1.061)+(2.044), (I-746)+(1.061)+(2.045), (I-746)+(1.061)+(2.046), (I-746)+(1.061)+(2.047), (I-746)+(1.061)+(2.048), (I-746)+(1.061)+(2.049), (I-746)+(1.061)+(2.050), (I-746)+(1.061)+(2.051), (I-746)+(1.061)+(2.052), (I-746)+(1.061)+(2.053), (I-746)+(1.061)+(2.054), (I-746)+(1.061)+(2.055), (I-746)+(1.061)+(2.056), (I-746)+(1.061)+(2.057), (I-746)+(1.061)+(2.058), (I-746)+(1.061)+(2.059), (I-746)+(1.061)+(3.001), (I-746)+(1.061)+(3.002), (I-746)+(1.061)+(3.003), (I-746)+(1.061)+(3.004), (I-746)+(1.061)+(3.005), (I-746)+(1.061)+(3.006), (I-746)+(1.061)+(3.007), (I-746)+(1.061)+(3.008), (I-746)+(1.061)+(3.009), (I-746)+(1.061)+(3.010), (I-746)+(1.061)+(3.011), (I-746)+(1.061)+(3.012), (I-746)+(1.061)+(3.013), (I-746)+(1.061)+(3.014), (I-746)+(1.061)+(3.015), (I-746)+(1.061)+(3.016), (I-746)+(1.061)+(3.017), (I-746)+(1.061)+(3.018), (I-746)+(1.061)+(3.019), (I-746)+(1.061)+(3.020), (I-746)+(1.061)+(3.021), (I-746)+(1.061)+(3.022), (I-746)+(1.061)+(3.023), (I-746)+(1.061)+(3.024), (I-746)+(1.061)+(3.025), (I-746)+(1.061)+(3.026), (I-746)+(1.061)+(3.027), (I-746)+(1.061)+(3.028), (I-746)+(1.061)+(3.029), (I-746)+(1.061)+(3.030), (I-746)+(1.061)+(3.031), (I-746)+(1.061)+(5.001), (I-746)+(1.061)+(5.002), (I-746)+(1.061)+(5.003), (I-746)+(1.061)+(5.004), (I-746)+(1.061)+(5.005), (I-746)+(1.061)+(5.006), (I-746)+(1.061)+(5.007), (I-746)+(1.061)+(5.008), (I-746)+(1.061)+(5.009), (I-746)+(1.061)+(5.010), (I-746)+(1.061)+(5.011), (I-746)+(1.061)+(5.012), (I-746)+(1.061)+(5.013), (I-746)+(1.061)+(5.014), (I-746)+(1.061)+(5.015), (I-746)+(1.061)+(5.016), (I-746)+(1.061)+(5.017), (I-746)+(1.061)+(5.018), (I-746)+(1.061)+(5.019), (I-746)+(1.061)+(5.020), (I-746)+(1.061)+(5.021), (I-746)+(1.061)+(5.022), (I-746)+(1.061)+(5.023), (I-746)+(1.061)+(6.001), (I-746)+(1.061)+(6.002), (I-746)+(1.061)+(6.003), (I-746)+(1.061)+(6.004), (I-746)+(1.061)+(7.001), (I-746)+(1.061)+(7.002), (I-746)+(1.061)+(7.003), (I-746)+(1.061)+(7.004), (I-746)+(1.061)+(7.005), (I-746)+(1.061)+(7.006), (I-746)+(1.061)+(9.001), (I-746)+(1.061)+(9.002), (I-746)+(1.061)+(9.003), (I-746)+(1.061)+(9.004), (I-746)+(1.061)+(9.005), (I-746)+(1.061)+(9.006), (I-746)+(1.061)+(9.007), (I-746)+(1.061)+(9.008), (I-746)+(1.061)+(9.009), (I-746)+(1.061)+(14.001), (I-746)+(1.061)+(14.002), (I-746)+(1.061)+(15.008), (I-746)+(1.061)+(15.011), (I-746)+(1.061)+(15.012), (I-746)+(1.061)+(15.016), (I-746)+(1.061)+(15.025), (I-746)+(1.061)+(15.027), (I-746)+(1.061)+(15.047), (I-746)+(1.061)+(15.063), (I-746)+(1.061)+(15.064), (I-746)+(1.061)+(16.001), (I-746)+(1.061)+(16.002), (I-746)+(1.061)+(16.003), (I-746)+(1.061)+(16.004), (I-746)+(1.061)+(16.005), (I-746)+(1.061)+(16.006), (I-746)+(1.061)+(16.007), (I-746)+(1.061)+(16.008), (I-746)+(1.061)+(17.001), (I-746)+(1.061)+(17.002), (I-746)+(1.061)+(17.003), (I-746)+(1.061)+(17.004), (I-746)+(1.061)+(17.005), (I-746)+(1.061)+(17.006), (I-746)+(1.061)+(17.007), (I-746)+(1.061)+(17.008), (I-746)+(1.061)+(17.009), (I-746)+(1.061)+(17.010), (I-746)+(1.061)+(17.011), (I-746)+(1.061)+(17.012), (I-746)+(1.061)+(18.001),

(I-746)+(1.062)+(1.063), (I-746)+(1.062)+(1.064), (I-746)+(1.062)+(1.065), (I-746)+(1.062)+(1.066), (I-746)+(1.062)+(1.067), (I-746)+(1.062)+(1.068), (I-746)+(1.062)+(1.069), (I-746)+(1.062)+(1.070), (I-746)+(1.062)+(1.071), (I-746)+(1.062)+(1.072), (I-746)+(1.062)+(1.073), (I-746)+(1.062)+(1.074), (I-746)+(1.062)+(1.075), (I-746)+(1.062)+(1.076), (I-746)+(1.062)+(1.077), (I-746)+(1.062)+(1.078), (I-746)+(1.062)+(1.079), (I-746)+(1.062)+(1.080), (I-746)+(1.062)+(1.081), (I-746)+(1.062)+(1.082), (I-746)+(1.062)+(1.083), (I-746)+(1.062)+(1.084), (I-746)+(1.062)+(1.085), (I-746)+(1.062)+(1.086), (I-746)+(1.062)+(1.087), (I-746)+(1.062)+(1.088), (I-746)+(1.062)+(1.089), (I-746)+(1.062)+(1.090), (I-746)+(1.062)+(1.091), (I-746)+(1.062)+(1.092), (I-746)+(1.062)+(2.001), (I-746)+(1.062)+(2.002), (I-746)+(1.062)+(2.003), (I-746)+(1.062)+(2.004), (I-746)+(1.062)+(2.005), (I-746)+(1.062)+(2.006), (I-746)+(1.062)+(2.007), (I-746)+(1.062)+(2.008), (I-746)+(1.062)+(2.009), (I-746)+(1.062)+(2.010), (I-746)+(1.062)+(2.011), (I-746)+(1.062)+(2.012), (I-746)+(1.062)+(2.013), (I-746)+(1.062)+(2.014), (I-746)+(1.062)+(2.015), (I-746)+(1.062)+(2.016), (I-746)+(1.062)+(2.017), (I-746)+(1.062)+(2.018), (I-746)+(1.062)+(2.019), (I-746)+(1.062)+(2.020), (I-746)+(1.062)+(2.021), (I-746)+(1.062)+(2.022), (I-746)+(1.062)+(2.023), (I-746)+(1.062)+(2.024), (I-746)+(1.062)+(2.025), (I-746)+(1.062)+(2.026), (I-746)+(1.062)+(2.027), (I-746)+(1.062)+(2.028), (I-746)+(1.062)+(2.029), (I-746)+(1.062)+(2.030), (I-746)+(1.062)+(2.031), (I-746)+(1.062)+(2.032), (I-746)+(1.062)+(2.033), (I-746)+(1.062)+(2.034), (I-746)+(1.062)+(2.035), (I-746)+(1.062)+(2.036), (I-746)+(1.062)+(2.037), (I-746)+(1.062)+(2.038), (I-746)+(1.062)+(2.039), (I-746)+(1.062)+(2.040), (I-746)+(1.062)+(2.041), (I-746)+(1.062)+(2.042), (I-746)+(1.062)+(2.043), (I-746)+(1.062)+(2.044), (I-746)+(1.062)+(2.045), (I-746)+(1.062)+(2.046), (I-746)+(1.062)+(2.047), (I-746)+(1.062)+(2.048), (I-746)+(1.062)+(2.049), (I-746)+(1.062)+(2.050), (I-746)+(1.062)+(2.051), (I-746)+(1.062)+(2.052), (I-746)+(1.062)+(2.053), (I-746)+(1.062)+(2.054), (I-746)+(1.062)+(2.055), (I-746)+(1.062)+(2.056), (I-746)+(1.062)+(2.057), (I-746)+(1.062)+(2.058), (I-746)+(1.062)+(2.059), (I-746)+(1.062)+(3.001), (I-746)+(1.062)+(3.002), (I-746)+(1.062)+(3.003), (I-746)+(1.062)+(3.004), (I-746)+(1.062)+(3.005), (I-746)+(1.062)+(3.006), (I-746)+(1.062)+(3.007), (I-746)+(1.062)+(3.008), (I-746)+(1.062)+(3.009), (I-746)+(1.062)+(3.010), (I-746)+(1.062)+(3.011), (I-746)+(1.062)+(3.012), (I-746)+(1.062)+(3.013), (I-746)+(1.062)+(3.014), (I-746)+(1.062)+(3.015), (I-746)+(1.062)+(3.016), (I-746)+(1.062)+(3.017), (I-746)+(1.062)+(3.018), (I-746)+(1.062)+(3.019), (I-746)+(1.062)+(3.020), (I-746)+(1.062)+(3.021), (I-746)+(1.062)+(3.022), (I-746)+(1.062)+(3.023), (I-746)+(1.062)+(3.024), (I-746)+(1.062)+(3.025), (I-746)+(1.062)+(3.026), (I-746)+(1.062)+(3.027), (I-746)+(1.062)+(3.028), (I-746)+(1.062)+(3.029), (I-746)+(1.062)+(3.030), (I-746)+(1.062)+(3.031), (I-746)+(1.062)+(5.001), (I-746)+(1.062)+(5.002), (I-746)+(1.062)+(5.003), (I-746)+(1.062)+(5.004), (I-746)+(1.062)+(5.005), (I-746)+(1.062)+(5.006), (I-746)+(1.062)+(5.007), (I-746)+(1.062)+(5.008), (I-746)+(1.062)+(5.009), (I-746)+(1.062)+(5.010), (I-746)+(1.062)+(5.011), (I-746)+(1.062)+(5.012), (I-746)+(1.062)+(5.013), (I-746)+(1.062)+(5.014), (I-746)+(1.062)+(5.015), (I-746)+(1.062)+(5.016), (I-746)+(1.062)+(5.017), (I-746)+(1.062)+(5.018), (I-746)+(1.062)+(5.019), (I-746)+(1.062)+(5.020), (I-746)+(1.062)+(5.021), (I-746)+(1.062)+(5.022), (I-746)+(1.062)+(5.023), (I-746)+(1.062)+(6.001), (I-746)+(1.062)+(6.002), (I-746)+(1.062)+(6.003), (I-746)+(1.062)+(6.004), (I-746)+(1.062)+(7.001), (I-746)+(1.062)+(7.002), (I-746)+(1.062)+(7.003), (I-746)+(1.062)+(7.004), (I-746)+(1.062)+(7.005), (I-746)+(1.062)+(7.006), (I-746)+(1.062)+(9.001), (I-746)+(1.062)+(9.002), (I-746)+(1.062)+(9.003), (I-746)+(1.062)+(9.004), (I-746)+(1.062)+(9.005), (I-746)+(1.062)+(9.006), (I-746)+(1.062)+(9.007), (I-746)+(1.062)+(9.008), (I-746)+(1.062)+(9.009), (I-746)+(1.062)+(14.001), (I-746)+(1.062)+(14.002), (I-746)+(1.062)+(15.008), (I-746)+(1.062)+(15.011), (I-746)+(1.062)+(15.012), (I-746)+(1.062)+(15.016), (I-746)+(1.062)+(15.025), (I-746)+(1.062)+(15.027), (I-746)+(1.062)+(15.047), (I-746)+(1.062)+(15.063), (I-746)+(1.062)+(15.064), (I-746)+(1.062)+(16.001), (I-746)+(1.062)+(16.002), (I-746)+(1.062)+(16.003), (I-746)+(1.062)+(16.004), (I-746)+(1.062)+(16.005), (I-746)+(1.062)+(16.006), (I-746)+(1.062)+(16.007), (I-746)+(1.062)+(16.008), (I-746)+(1.062)+(17.001), (I-746)+(1.062)+(17.002), (I-746)+(1.062)+(17.003), (I-746)+(1.062)+(17.004), (I-746)+(1.062)+(17.005), (I-746)+(1.062)+(17.006), (I-746)+(1.062)+(17.007), (I-746)+(1.062)+(17.008), (I-746)+(1.062)+(17.009), (I-746)+(1.062)+(17.010), (I-746)+(1.062)+(17.011), (I-746)+(1.062)+(17.012), (I-746)+(1.062)+(18.001),

(I-746)+(1.063)+(1.064), (I-746)+(1.063)+(1.065), (I-746)+(1.063)+(1.066), (I-746)+(1.063)+(1.067), (I-746)+(1.063)+(1.068), (I-746)+(1.063)+(1.069), (I-746)+(1.063)+(1.070), (I-746)+(1.063)+(1.071), (I-746)+(1.063)+(1.072), (I-746)+(1.063)+(1.073), (I-746)+(1.063)+(1.074), (I-746)+(1.063)+(1.075), (I-746)+(1.063)+(1.076), (I-746)+(1.063)+(1.077), (I-746)+(1.063)+(1.078), (I-746)+(1.063)+(1.079), (I-746)+(1.063)+(1.080), (I-746)+(1.063)+(1.081), (I-746)+(1.063)+(1.082), (I-746)+(1.063)+(1.083), (I-746)+(1.063)+(1.084), (I-746)+(1.063)+(1.085), (I-746)+(1.063)+(1.086), (I-746)+(1.063)+(1.087), (I-746)+(1.063)+(1.088), (I-746)+(1.063)+(1.089), (I-746)+(1.063)+(1.090), (I-746)+(1.063)+(1.091), (I-746)+(1.063)+(1.092), (I-746)+(1.063)+(2.001), (I-746)+(1.063)+(2.002), (I-746)+(1.063)+(2.003), (I-746)+(1.063)+(2.004), (I-746)+(1.063)+(2.005), (I-746)+(1.063)+(2.006), (I-746)+(1.063)+(2.007), (I-746)+(1.063)+(2.008), (I-746)+(1.063)+(2.009), (I-746)+(1.063)+(2.010), (I-746)+(1.063)+(2.011), (I-746)+(1.063)+(2.012), (I-746)+(1.063)+(2.013), (I-746)+(1.063)+(2.014), (I-746)+(1.063)+(2.015), (I-746)+(1.063)+(2.016), (I-746)+(1.063)+(2.017), (I-746)+(1.063)+(2.018), (I-746)+(1.063)+(2.019), (I-746)+(1.063)+(2.020), (I-746)+(1.063)+(2.021), (I-746)+(1.063)+(2.022), (I-746)+(1.063)+(2.023), (I-746)+(1.063)+(2.024), (I-746)+(1.063)+(2.025), (I-746)+(1.063)+(2.026), (I-746)+(1.063)+(2.027), (I-746)+(1.063)+(2.028), (I-746)+(1.063)+(2.029), (I-746)+(1.063)+(2.030), (I-746)+(1.063)+(2.031), (I-746)+(1.063)+(2.032), (I-746)+(1.063)+(2.033), (I-746)+(1.063)+(2.034), (I-746)+(1.063)+(2.035), (I-746)+(1.063)+(2.036), (I-746)+(1.063)+(2.037), (I-746)+(1.063)+(2.038), (I-746)+(1.063)+(2.039), (I-746)+(1.063)+(2.040), (I-746)+(1.063)+(2.041), (I-746)+(1.063)+(2.042), (I-746)+(1.063)+(2.043), (I-746)+(1.063)+(2.044), (I-746)+(1.063)+(2.045), (I-746)+(1.063)+(2.046), (I-746)+(1.063)+(2.047), (I-746)+(1.063)+(2.048), (I-746)+(1.063)+(2.049), (I-746)+(1.063)+(2.050), (I-746)+(1.063)+(2.051), (I-746)+(1.063)+(2.052), (I-746)+(1.063)+(2.053), (I-746)+(1.063)+(2.054), (I-746)+(1.063)+(2.055), (I-746)+(1.063)+(2.056), (I-746)+(1.063)+(2.057), (I-746)+(1.063)+(2.058), (I-746)+(1.063)+(2.059), (I-746)+(1.063)+(3.001), (I-746)+(1.063)+(3.002), (I-746)+(1.063)+(3.003), (I-746)+(1.063)+(3.004), (I-746)+(1.063)+(3.005), (I-746)+(1.063)+(3.006), (I-746)+(1.063)+(3.007), (I-746)+(1.063)+(3.008), (I-746)+(1.063)+(3.009), (I-746)+(1.063)+(3.010), (I-746)+(1.063)+(3.011), (I-746)+(1.063)+(3.012), (I-746)+(1.063)+(3.013), (I-746)+(1.063)+(3.014), (I-746)+(1.063)+(3.015), (I-746)+(1.063)+(3.016), (I-746)+(1.063)+(3.017), (I-746)+(1.063)+(3.018), (I-746)+(1.063)+(3.019), (I-746)+(1.063)+(3.020), (I-746)+(1.063)+(3.021), (I-746)+(1.063)+(3.022), (I-746)+(1.063)+(3.023), (I-746)+(1.063)+(3.024), (I-746)+(1.063)+(3.025), (I-746)+(1.063)+(3.026), (I-746)+(1.063)+(3.027), (I-746)+(1.063)+(3.028), (I-746)+(1.063)+(3.029), (I-746)+(1.063)+(3.030), (I-746)+(1.063)+(3.031), (I-746)+(1.063)+(5.001), (I-746)+(1.063)+(5.002), (I-746)+(1.063)+(5.003), (I-746)+(1.063)+(5.004), (I-746)+(1.063)+(5.005), (I-746)+(1.063)+(5.006), (I-746)+(1.063)+(5.007), (I-746)+(1.063)+(5.008), (I-746)+(1.063)+(5.009), (I-746)+(1.063)+(5.010), (I-746)+(1.063)+(5.011), (I-746)+(1.063)+(5.012), (I-746)+(1.063)+(5.013), (I-746)+(1.063)+(5.014), (I-746)+(1.063)+(5.015), (I-746)+(1.063)+(5.016), (I-746)+(1.063)+(5.017), (I-746)+(1.063)+(5.018), (I-746)+(1.063)+(5.019), (I-746)+(1.063)+(5.020), (I-746)+(1.063)+(5.021), (I-746)+(1.063)+(5.022), (I-746)+(1.063)+(5.023), (I-746)+(1.063)+(6.001), (I-746)+(1.063)+(6.002), (I-746)+(1.063)+(6.003), (I-746)+(1.063)+(6.004), (I-746)+(1.063)+(7.001), (I-746)+(1.063)+(7.002), (I-746)+(1.063)+(7.003), (I-746)+(1.063)+(7.004), (I-746)+(1.063)+(7.005), (I-746)+(1.063)+(7.006), (I-746)+(1.063)+(9.001), (I-746)+(1.063)+(9.002), (I-746)+(1.063)+(9.003), (I-746)+(1.063)+(9.004), (I-746)+(1.063)+(9.005), (I-746)+(1.063)+(9.006), (I-746)+(1.063)+(9.007), (I-746)+(1.063)+(9.008), (I-746)+(1.063)+(9.009), (I-746)+(1.063)+(14.001), (I-746)+(1.063)+(14.002), (I-746)+(1.063)+(15.008), (I-746)+(1.063)+(15.011), (I-746)+(1.063)+(15.012), (I-746)+(1.063)+(15.016), (I-746)+(1.063)+(15.025), (I-746)+(1.063)+(15.027), (I-746)+(1.063)+(15.047), (I-746)+(1.063)+(15.063), (I-746)+(1.063)+(15.064), (I-746)+(1.063)+(16.001), (I-746)+(1.063)+(16.002), (I-746)+(1.063)+(16.003), (I-746)+(1.063)+(16.004), (I-746)+(1.063)+(16.005), (I-746)+(1.063)+(16.006), (I-746)+(1.063)+(16.007), (I-746)+(1.063)+(16.008), (I-746)+(1.063)+(17.001), (I-746)+(1.063)+(17.002), (I-746)+(1.063)+(17.003), (I-746)+(1.063)+(17.004), (I-746)+(1.063)+(17.005), (I-746)+(1.063)+(17.006), (I-746)+(1.063)+(17.007), (I-746)+(1.063)+(17.008), (I-746)+(1.063)+(17.009), (I-746)+(1.063)+(17.010), (I-746)+(1.063)+(17.011), (I-746)+(1.063)+(17.012), (I-746)+(1.063)+(18.001),

(I-746)+(1.064)+(1.065), (I-746)+(1.064)+(1.066), (I-746)+(1.064)+(1.067), (I-746)+(1.064)+(1.068), (I-746)+(1.064)+(1.069), (I-746)+(1.064)+(1.070), (I-746)+(1.064)+(1.071), (I-746)+(1.064)+(1.072), (I-746)+(1.064)+(1.073), (I-746)+(1.064)+(1.074), (I-746)+(1.064)+(1.075), (I-746)+(1.064)+(1.076), (I-746)+(1.064)+(1.077), (I-746)+(1.064)+(1.078), (I-746)+(1.064)+(1.079), (I-746)+(1.064)+(1.080), (I-746)+(1.064)+(1.081), (I-746)+(1.064)+(1.082), (I-746)+(1.064)+(1.083), (I-746)+(1.064)+(1.084), (I-746)+(1.064)+(1.085), (I-746)+(1.064)+(1.086), (I-746)+(1.064)+(1.087), (I-746)+(1.064)+(1.088), (I-746)+(1.064)+(1.089), (I-746)+(1.064)+(1.090), (I-746)+(1.064)+(1.091), (I-746)+(1.064)+(1.092), (I-746)+(1.064)+(2.001), (I-746)+(1.064)+(2.002), (I-746)+(1.064)+(2.003), (I-746)+(1.064)+(2.004), (I-746)+(1.064)+(2.005), (I-746)+(1.064)+(2.006), (I-746)+(1.064)+(2.007), (I-746)+(1.064)+(2.008), (I-746)+(1.064)+(2.009), (I-746)+(1.064)+(2.010), (I-746)+(1.064)+(2.011), (I-746)+(1.064)+(2.012), (I-746)+(1.064)+(2.013), (I-746)+(1.064)+(2.014), (I-746)+(1.064)+(2.015), (I-746)+(1.064)+(2.016), (I-746)+(1.064)+(2.017), (I-746)+(1.064)+(2.018), (I-746)+(1.064)+(2.019), (I-746)+(1.064)+(2.020), (I-746)+(1.064)+(2.021), (I-746)+(1.064)+(2.022), (I-746)+(1.064)+(2.023), (I-746)+(1.064)+(2.024), (I-746)+(1.064)+(2.025), (I-746)+(1.064)+(2.026), (I-746)+(1.064)+(2.027), (I-746)+(1.064)+(2.028), (I-746)+(1.064)+(2.029), (I-746)+(1.064)+(2.030), (I-746)+(1.064)+(2.031), (I-746)+(1.064)+(2.032), (I-746)+(1.064)+(2.033), (I-746)+(1.064)+(2.034), (I-746)+(1.064)+(2.035), (I-746)+(1.064)+(2.036), (I-746)+(1.064)+(2.037), (I-746)+(1.064)+(2.038), (I-746)+(1.064)+(2.039), (I-746)+(1.064)+(2.040), (I-746)+(1.064)+(2.041), (I-746)+(1.064)+(2.042), (I-746)+(1.064)+(2.043), (I-746)+(1.064)+(2.044), (I-746)+(1.064)+(2.045), (I-746)+(1.064)+(2.046), (I-746)+(1.064)+(2.047), (I-746)+(1.064)+(2.048), (I-746)+(1.064)+(2.049), (I-746)+(1.064)+(2.050), (I-746)+(1.064)+(2.051), (I-746)+(1.064)+(2.052), (I-746)+(1.064)+(2.053), (I-746)+(1.064)+(2.054), (I-746)+(1.064)+(2.055), (I-746)+(1.064)+(2.056), (I-746)+(1.064)+(2.057), (I-746)+(1.064)+(2.058), (I-746)+(1.064)+(2.059), (I-746)+(1.064)+(3.001), (I-746)+(1.064)+(3.002), (I-746)+(1.064)+(3.003), (I-746)+(1.064)+(3.004), (I-746)+(1.064)+(3.005), (I-746)+(1.064)+(3.006), (I-746)+(1.064)+(3.007), (I-746)+(1.064)+(3.008), (I-746)+(1.064)+(3.009), (I-746)+(1.064)+(3.010), (I-746)+(1.064)+(3.011), (I-746)+(1.064)+(3.012), (I-746)+(1.064)+(3.013), (I-746)+(1.064)+(3.014), (I-746)+(1.064)+(3.015), (I-746)+(1.064)+(3.016), (I-746)+(1.064)+(3.017), (I-746)+(1.064)+(3.018), (I-746)+(1.064)+(3.019), (I-746)+(1.064)+(3.020), (I-746)+(1.064)+(3.021), (I-746)+(1.064)+(3.022), (I-746)+(1.064)+(3.023), (I-746)+(1.064)+(3.024), (I-746)+(1.064)+(3.025), (I-746)+(1.064)+(3.026), (I-746)+(1.064)+(3.027), (I-746)+(1.064)+(3.028), (I-746)+(1.064)+(3.029), (I-746)+(1.064)+(3.030), (I-746)+(1.064)+(3.031), (I-746)+(1.064)+(5.001), (I-746)+(1.064)+(5.002), (I-746)+(1.064)+(5.003), (I-746)+(1.064)+(5.004), (I-746)+(1.064)+(5.005), (I-746)+(1.064)+(5.006), (I-746)+(1.064)+(5.007), (I-746)+(1.064)+(5.008), (I-746)+(1.064)+(5.009), (I-746)+(1.064)+(5.010), (I-746)+(1.064)+(5.011), (I-746)+(1.064)+(5.012), (I-746)+(1.064)+(5.013), (I-746)+(1.064)+(5.014), (I-746)+(1.064)+(5.015), (I-746)+(1.064)+(5.016), (I-746)+(1.064)+(5.017), (I-746)+(1.064)+(5.018), (I-746)+(1.064)+(5.019), (I-746)+(1.064)+(5.020), (I-746)+(1.064)+(5.021), (I-746)+(1.064)+(5.022), (I-746)+(1.064)+(5.023), (I-746)+(1.064)+(6.001), (I-746)+(1.064)+(6.002), (I-746)+(1.064)+(6.003), (I-746)+(1.064)+(6.004), (I-746)+(1.064)+(7.001), (I-746)+(1.064)+(7.002), (I-746)+(1.064)+(7.003), (I-746)+(1.064)+(7.004), (I-746)+(1.064)+(7.005), (I-746)+(1.064)+(7.006), (I-746)+(1.064)+(9.001), (I-746)+(1.064)+(9.002), (I-746)+(1.064)+(9.003), (I-746)+(1.064)+(9.004), (I-746)+(1.064)+(9.005), (I-746)+(1.064)+(9.006), (I-746)+(1.064)+(9.007), (I-746)+(1.064)+(9.008), (I-746)+(1.064)+(9.009), (I-746)+(1.064)+(14.001), (I-746)+(1.064)+(14.002), (I-746)+(1.064)+(15.008), (I-746)+(1.064)+(15.011), (I-746)+(1.064)+(15.012), (I-746)+(1.064)+(15.016), (I-746)+(1.064)+(15.025), (I-746)+(1.064)+(15.027), (I-746)+(1.064)+(15.047), (I-746)+(1.064)+(15.063), (I-746)+(1.064)+(15.064), (I-746)+(1.064)+(16.001), (I-746)+(1.064)+(16.002), (I-746)+(1.064)+(16.003), (I-746)+(1.064)+(16.004), (I-746)+(1.064)+(16.005), (I-746)+(1.064)+(16.006), (I-746)+(1.064)+(16.007), (I-746)+(1.064)+(16.008), (I-746)+(1.064)+(17.001), (I-746)+(1.064)+(17.002), (I-746)+(1.064)+(17.003), (I-746)+(1.064)+(17.004), (I-746)+(1.064)+(17.005), (I-746)+(1.064)+(17.006), (I-746)+(1.064)+(17.007), (I-746)+(1.064)+(17.008), (I-746)+(1.064)+(17.009), (I-746)+(1.064)+(17.010), (I-746)+(1.064)+(17.011), (I-746)+(1.064)+(17.012), (I-746)+(1.064)+(18.001),

(I-746)+(1.065)+(1.066), (I-746)+(1.065)+(1.067), (I-746)+(1.065)+(1.068), (I-746)+(1.065)+(1.069), (I-746)+(1.065)+(1.070), (I-746)+(1.065)+(1.071), (I-746)+(1.065)+(1.072), (I-746)+(1.065)+(1.073), (I-746)+(1.065)+(1.074), (I-746)+(1.065)+(1.075), (I-746)+(1.065)+(1.076), (I-746)+(1.065)+(1.077), (I-746)+(1.065)+(1.078), (I-746)+(1.065)+(1.079), (I-746)+(1.065)+(1.080), (I-746)+(1.065)+(1.081), (I-746)+(1.065)+(1.082), (I-746)+(1.065)+(1.083), (I-746)+(1.065)+(1.084), (I-746)+(1.065)+(1.085), (I-746)+(1.065)+(1.086), (I-746)+(1.065)+(1.087), (I-746)+(1.065)+(1.088), (I-746)+(1.065)+(1.089), (I-746)+(1.065)+(1.090), (I-746)+(1.065)+(1.091), (I-746)+(1.065)+(1.092), (I-746)+(1.065)+(2.001), (I-746)+(1.065)+(2.002), (I-746)+(1.065)+(2.003), (I-746)+(1.065)+(2.004), (I-746)+(1.065)+(2.005), (I-746)+(1.065)+(2.006), (I-746)+(1.065)+(2.007), (I-746)+(1.065)+(2.008), (I-746)+(1.065)+(2.009), (I-746)+(1.065)+(2.010), (I-746)+(1.065)+(2.011), (I-746)+(1.065)+(2.012), (I-746)+(1.065)+(2.013), (I-746)+(1.065)+(2.014), (I-746)+(1.065)+(2.015), (I-746)+(1.065)+(2.016), (I-746)+(1.065)+(2.017), (I-746)+(1.065)+(2.018), (I-746)+(1.065)+(2.019), (I-746)+(1.065)+(2.020), (I-746)+(1.065)+(2.021), (I-746)+(1.065)+(2.022), (I-746)+(1.065)+(2.023), (I-746)+(1.065)+(2.024), (I-746)+(1.065)+(2.025), (I-746)+(1.065)+(2.026), (I-746)+(1.065)+(2.027), (I-746)+(1.065)+(2.028), (I-746)+(1.065)+(2.029), (I-746)+(1.065)+(2.030), (I-746)+(1.065)+(2.031), (I-746)+(1.065)+(2.032), (I-746)+(1.065)+(2.033), (I-746)+(1.065)+(2.034), (I-746)+(1.065)+(2.035), (I-746)+(1.065)+(2.036), (I-746)+(1.065)+(2.037), (I-746)+(1.065)+(2.038), (I-746)+(1.065)+(2.039), (I-746)+(1.065)+(2.040), (I-746)+(1.065)+(2.041), (I-746)+(1.065)+(2.042), (I-746)+(1.065)+(2.043), (I-746)+(1.065)+(2.044), (I-746)+(1.065)+(2.045), (I-746)+(1.065)+(2.046), (I-746)+(1.065)+(2.047), (I-746)+(1.065)+(2.048), (I-746)+(1.065)+(2.049), (I-746)+(1.065)+(2.050), (I-746)+(1.065)+(2.051), (I-746)+(1.065)+(2.052), (I-746)+(1.065)+(2.053), (I-746)+(1.065)+(2.054), (I-746)+(1.065)+(2.055), (I-746)+(1.065)+(2.056), (I-746)+(1.065)+(2.057), (I-746)+(1.065)+(2.058), (I-746)+(1.065)+(2.059), (I-746)+(1.065)+(3.001), (I-746)+(1.065)+(3.002), (I-746)+(1.065)+(3.003), (I-746)+(1.065)+(3.004), (I-746)+(1.065)+(3.005), (I-746)+(1.065)+(3.006), (I-746)+(1.065)+(3.007), (I-746)+(1.065)+(3.008), (I-746)+(1.065)+(3.009), (I-746)+(1.065)+(3.010), (I-746)+(1.065)+(3.011), (I-746)+(1.065)+(3.012), (I-746)+(1.065)+(3.013), (I-746)+(1.065)+(3.014), (I-746)+(1.065)+(3.015), (I-746)+(1.065)+(3.016), (I-746)+(1.065)+(3.017), (I-746)+(1.065)+(3.018), (I-746)+(1.065)+(3.019), (I-746)+(1.065)+(3.020), (I-746)+(1.065)+(3.021), (I-746)+(1.065)+(3.022), (I-746)+(1.065)+(3.023), (I-746)+(1.065)+(3.024), (I-746)+(1.065)+(3.025), (I-746)+(1.065)+(3.026), (I-746)+(1.065)+(3.027), (I-746)+(1.065)+(3.028), (I-746)+(1.065)+(3.029), (I-746)+(1.065)+(3.030), (I-746)+(1.065)+(3.031), (I-746)+(1.065)+(5.001), (I-746)+(1.065)+(5.002), (I-746)+(1.065)+(5.003), (I-746)+(1.065)+(5.004), (I-746)+(1.065)+(5.005), (I-746)+(1.065)+(5.006), (I-746)+(1.065)+(5.007), (I-746)+(1.065)+(5.008), (I-746)+(1.065)+(5.009), (I-746)+(1.065)+(5.010), (I-746)+(1.065)+(5.011), (I-746)+(1.065)+(5.012), (I-746)+(1.065)+(5.013), (I-746)+(1.065)+(5.014), (I-746)+(1.065)+(5.015), (I-746)+(1.065)+(5.016), (I-746)+(1.065)+(5.017), (I-746)+(1.065)+(5.018), (I-746)+(1.065)+(5.019), (I-746)+(1.065)+(5.020), (I-746)+(1.065)+(5.021), (I-746)+(1.065)+(5.022), (I-746)+(1.065)+(5.023), (I-746)+(1.065)+(6.001), (I-746)+(1.065)+(6.002), (I-746)+(1.065)+(6.003), (I-746)+(1.065)+(6.004), (I-746)+(1.065)+(7.001), (I-746)+(1.065)+(7.002), (I-746)+(1.065)+(7.003), (I-746)+(1.065)+(7.004), (I-746)+(1.065)+(7.005), (I-746)+(1.065)+(7.006), (I-746)+(1.065)+(9.001), (I-746)+(1.065)+(9.002), (I-746)+(1.065)+(9.003), (I-746)+(1.065)+(9.004), (I-746)+(1.065)+(9.005), (I-746)+(1.065)+(9.006), (I-746)+(1.065)+(9.007), (I-746)+(1.065)+(9.008), (I-746)+(1.065)+(9.009), (I-746)+(1.065)+(14.001), (I-746)+(1.065)+(14.002), (I-746)+(1.065)+(15.008), (I-746)+(1.065)+(15.011), (I-746)+(1.065)+(15.012), (I-746)+(1.065)+(15.016), (I-746)+(1.065)+(15.025), (I-746)+(1.065)+(15.027), (I-746)+(1.065)+(15.047), (I-746)+(1.065)+(15.063), (I-746)+(1.065)+(15.064), (I-746)+(1.065)+(16.001), (I-746)+(1.065)+(16.002), (I-746)+(1.065)+(16.003), (I-746)+(1.065)+(16.004), (I-746)+(1.065)+(16.005), (I-746)+(1.065)+(16.006), (I-746)+(1.065)+(16.007), (I-746)+(1.065)+(16.008), (I-746)+(1.065)+(17.001), (I-746)+(1.065)+(17.002), (I-746)+(1.065)+(17.003), (I-746)+(1.065)+(17.004), (I-746)+(1.065)+(17.005), (I-746)+(1.065)+(17.006), (I-746)+(1.065)+(17.007), (I-746)+(1.065)+(17.008), (I-746)+(1.065)+(17.009), (I-746)+(1.065)+(17.010), (I-746)+(1.065)+(17.011), (I-746)+(1.065)+(17.012), (I-746)+(1.065)+(18.001),

(I-746)+(1.066)+(1.067), (I-746)+(1.066)+(1.068), (I-746)+(1.066)+(1.069), (I-746)+(1.066)+(1.070), (I-746)+(1.066)+(1.071), (I-746)+(1.066)+(1.072), (I-746)+(1.066)+(1.073), (I-746)+(1.066)+(1.074), (I-746)+(1.066)+(1.075), (I-746)+(1.066)+(1.076), (I-746)+(1.066)+(1.077), (I-746)+(1.066)+(1.078), (I-746)+(1.066)+(1.079), (I-746)+(1.066)+(1.080), (I-746)+(1.066)+(1.081), (I-746)+(1.066)+(1.082), (I-746)+(1.066)+(1.083), (I-746)+(1.066)+(1.084), (I-746)+(1.066)+(1.085), (I-746)+(1.066)+(1.086), (I-746)+(1.066)+(1.087), (I-746)+(1.066)+(1.088), (I-746)+(1.066)+(1.089), (I-746)+(1.066)+(1.090), (I-746)+(1.066)+(1.091), (I-746)+(1.066)+(1.092), (I-746)+(1.066)+(2.001), (I-746)+(1.066)+(2.002), (I-746)+(1.066)+(2.003), (I-746)+(1.066)+(2.004), (I-746)+(1.066)+(2.005), (I-746)+(1.066)+(2.006), (I-746)+(1.066)+(2.007), (I-746)+(1.066)+(2.008), (I-746)+(1.066)+(2.009), (I-746)+(1.066)+(2.010), (I-746)+(1.066)+(2.011), (I-746)+(1.066)+(2.012), (I-746)+(1.066)+(2.013), (I-746)+(1.066)+(2.014), (I-746)+(1.066)+(2.015), (I-746)+(1.066)+(2.016), (I-746)+(1.066)+(2.017), (I-746)+(1.066)+(2.018), (I-746)+(1.066)+(2.019), (I-746)+(1.066)+(2.020), (I-746)+(1.066)+(2.021), (I-746)+(1.066)+(2.022), (I-746)+(1.066)+(2.023), (I-746)+(1.066)+(2.024), (I-746)+(1.066)+(2.025), (I-746)+(1.066)+(2.026), (I-746)+(1.066)+(2.027), (I-746)+(1.066)+(2.028), (I-746)+(1.066)+(2.029), (I-746)+(1.066)+(2.030), (I-746)+(1.066)+(2.031), (I-746)+(1.066)+(2.032), (I-746)+(1.066)+(2.033), (I-746)+(1.066)+(2.034), (I-746)+(1.066)+(2.035), (I-746)+(1.066)+(2.036), (I-746)+(1.066)+(2.037), (I-746)+(1.066)+(2.038), (I-746)+(1.066)+(2.039), (I-746)+(1.066)+(2.040), (I-746)+(1.066)+(2.041), (I-746)+(1.066)+(2.042), (I-746)+(1.066)+(2.043), (I-746)+(1.066)+(2.044), (I-746)+(1.066)+(2.045), (I-746)+(1.066)+(2.046), (I-746)+(1.066)+(2.047), (I-746)+(1.066)+(2.048), (I-746)+(1.066)+(2.049), (I-746)+(1.066)+(2.050), (I-746)+(1.066)+(2.051), (I-746)+(1.066)+(2.052), (I-746)+(1.066)+(2.053), (I-746)+(1.066)+(2.054), (I-746)+(1.066)+(2.055), (I-746)+(1.066)+(2.056), (I-746)+(1.066)+(2.057), (I-746)+(1.066)+(2.058), (I-746)+(1.066)+(2.059), (I-746)+(1.066)+(3.001), (I-746)+(1.066)+(3.002), (I-746)+(1.066)+(3.003), (I-746)+(1.066)+(3.004), (I-746)+(1.066)+(3.005), (I-746)+(1.066)+(3.006), (I-746)+(1.066)+(3.007), (I-746)+(1.066)+(3.008), (I-746)+(1.066)+(3.009), (I-746)+(1.066)+(3.010), (I-746)+(1.066)+(3.011), (I-746)+(1.066)+(3.012), (I-746)+(1.066)+(3.013), (I-746)+(1.066)+(3.014), (I-746)+(1.066)+(3.015), (I-746)+(1.066)+(3.016), (I-746)+(1.066)+(3.017), (I-746)+(1.066)+(3.018), (I-746)+(1.066)+(3.019), (I-746)+(1.066)+(3.020), (I-746)+(1.066)+(3.021), (I-746)+(1.066)+(3.022), (I-746)+(1.066)+(3.023), (I-746)+(1.066)+(3.024), (I-746)+(1.066)+(3.025), (I-746)+(1.066)+(3.026), (I-746)+(1.066)+(3.027), (I-746)+(1.066)+(3.028), (I-746)+(1.066)+(3.029), (I-746)+(1.066)+(3.030), (I-746)+(1.066)+(3.031), (I-746)+(1.066)+(5.001), (I-746)+(1.066)+(5.002), (I-746)+(1.066)+(5.003), (I-746)+(1.066)+(5.004), (I-746)+(1.066)+(5.005), (I-746)+(1.066)+(5.006), (I-746)+(1.066)+(5.007), (I-746)+(1.066)+(5.008), (I-746)+(1.066)+(5.009), (I-746)+(1.066)+(5.010), (I-746)+(1.066)+(5.011), (I-746)+(1.066)+(5.012), (I-746)+(1.066)+(5.013), (I-746)+(1.066)+(5.014), (I-746)+(1.066)+(5.015), (I-746)+(1.066)+(5.016), (I-746)+(1.066)+(5.017), (I-746)+(1.066)+(5.018), (I-746)+(1.066)+(5.019), (I-746)+(1.066)+(5.020), (I-746)+(1.066)+(5.021), (I-746)+(1.066)+(5.022), (I-746)+(1.066)+(5.023), (I-746)+(1.066)+(6.001), (I-746)+(1.066)+(6.002), (I-746)+(1.066)+(6.003), (I-746)+(1.066)+(6.004), (I-746)+(1.066)+(7.001), (I-746)+(1.066)+(7.002), (I-746)+(1.066)+(7.003), (I-746)+(1.066)+(7.004), (I-746)+(1.066)+(7.005), (I-746)+(1.066)+(7.006), (I-746)+(1.066)+(9.001), (I-746)+(1.066)+(9.002), (I-746)+(1.066)+(9.003), (I-746)+(1.066)+(9.004), (I-746)+(1.066)+(9.005), (I-746)+(1.066)+(9.006), (I-746)+(1.066)+(9.007), (I-746)+(1.066)+(9.008), (I-746)+(1.066)+(9.009), (I-746)+(1.066)+(14.001), (I-746)+(1.066)+(14.002), (I-746)+(1.066)+(15.008), (I-746)+(1.066)+(15.011), (I-746)+(1.066)+(15.012), (I-746)+(1.066)+(15.016), (I-746)+(1.066)+(15.025), (I-746)+(1.066)+(15.027), (I-746)+(1.066)+(15.047), (I-746)+(1.066)+(15.063), (I-746)+(1.066)+(15.064), (I-746)+(1.066)+(16.001), (I-746)+(1.066)+(16.002), (I-746)+(1.066)+(16.003), (I-746)+(1.066)+(16.004), (I-746)+(1.066)+(16.005), (I-746)+(1.066)+(16.006), (I-746)+(1.066)+(16.007), (I-746)+(1.066)+(16.008), (I-746)+(1.066)+(17.001), (I-746)+(1.066)+(17.002), (I-746)+(1.066)+(17.003), (I-746)+(1.066)+(17.004), (I-746)+(1.066)+(17.005), (I-746)+(1.066)+(17.006), (I-746)+(1.066)+(17.007), (I-746)+(1.066)+(17.008), (I-746)+(1.066)+(17.009), (I-746)+(1.066)+(17.010), (I-746)+(1.066)+(17.011), (I-746)+(1.066)+(17.012), (I-746)+(1.066)+(18.001),

(I-746)+(1.067)+(1.068), (I-746)+(1.067)+(1.069), (I-746)+(1.067)+(1.070), (I-746)+(1.067)+(1.071), (I-746)+(1.067)+(1.072), (I-746)+(1.067)+(1.073), (I-746)+(1.067)+(1.074), (I-746)+(1.067)+(1.075), (I-746)+(1.067)+(1.076), (I-746)+(1.067)+(1.077), (I-746)+(1.067)+(1.078), (I-746)+(1.067)+(1.079), (I-746)+(1.067)+(1.080), (I-746)+(1.067)+(1.081), (I-746)+(1.067)+(1.082), (I-746)+(1.067)+(1.083), (I-746)+(1.067)+(1.084), (I-746)+(1.067)+(1.085), (I-746)+(1.067)+(1.086), (I-746)+(1.067)+(1.087), (I-746)+(1.067)+(1.088), (I-746)+(1.067)+(1.089), (I-746)+(1.067)+(1.090), (I-746)+(1.067)+(1.091), (I-746)+(1.067)+(1.092), (I-746)+(1.067)+(2.001), (I-746)+(1.067)+(2.002), (I-746)+(1.067)+(2.003), (I-746)+(1.067)+(2.004), (I-746)+(1.067)+(2.005), (I-746)+(1.067)+(2.006), (I-746)+(1.067)+(2.007), (I-746)+(1.067)+(2.008), (I-746)+(1.067)+(2.009), (I-746)+(1.067)+(2.010), (I-746)+(1.067)+(2.011), (I-746)+(1.067)+(2.012), (I-746)+(1.067)+(2.013), (I-746)+(1.067)+(2.014), (I-746)+(1.067)+(2.015), (I-746)+(1.067)+(2.016), (I-746)+(1.067)+(2.017), (I-746)+(1.067)+(2.018), (I-746)+(1.067)+(2.019), (I-746)+(1.067)+(2.020), (I-746)+(1.067)+(2.021), (I-746)+(1.067)+(2.022), (I-746)+(1.067)+(2.023), (I-746)+(1.067)+(2.024), (I-746)+(1.067)+(2.025), (I-746)+(1.067)+(2.026), (I-746)+(1.067)+(2.027), (I-746)+(1.067)+(2.028), (I-746)+(1.067)+(2.029), (I-746)+(1.067)+(2.030), (I-746)+(1.067)+(2.031), (I-746)+(1.067)+(2.032), (I-746)+(1.067)+(2.033), (I-746)+(1.067)+(2.034), (I-746)+(1.067)+(2.035), (I-746)+(1.067)+(2.036), (I-746)+(1.067)+(2.037), (I-746)+(1.067)+(2.038), (I-746)+(1.067)+(2.039), (I-746)+(1.067)+(2.040), (I-746)+(1.067)+(2.041), (I-746)+(1.067)+(2.042), (I-746)+(1.067)+(2.043), (I-746)+(1.067)+(2.044), (I-746)+(1.067)+(2.045), (I-746)+(1.067)+(2.046), (I-746)+(1.067)+(2.047), (I-746)+(1.067)+(2.048), (I-746)+(1.067)+(2.049), (I-746)+(1.067)+(2.050), (I-746)+(1.067)+(2.051), (I-746)+(1.067)+(2.052), (I-746)+(1.067)+(2.053), (I-746)+(1.067)+(2.054), (I-746)+(1.067)+(2.055), (I-746)+(1.067)+(2.056), (I-746)+(1.067)+(2.057), (I-746)+(1.067)+(2.058), (I-746)+(1.067)+(2.059), (I-746)+(1.067)+(3.001), (I-746)+(1.067)+(3.002), (I-746)+(1.067)+(3.003), (I-746)+(1.067)+(3.004), (I-746)+(1.067)+(3.005), (I-746)+(1.067)+(3.006), (I-746)+(1.067)+(3.007), (I-746)+(1.067)+(3.008), (I-746)+(1.067)+(3.009), (I-746)+(1.067)+(3.010), (I-746)+(1.067)+(3.011), (I-746)+(1.067)+(3.012), (I-746)+(1.067)+(3.013), (I-746)+(1.067)+(3.014), (I-746)+(1.067)+(3.015), (I-746)+(1.067)+(3.016), (I-746)+(1.067)+(3.017), (I-746)+(1.067)+(3.018), (I-746)+(1.067)+(3.019), (I-746)+(1.067)+(3.020), (I-746)+(1.067)+(3.021), (I-746)+(1.067)+(3.022), (I-746)+(1.067)+(3.023), (I-746)+(1.067)+(3.024), (I-746)+(1.067)+(3.025), (I-746)+(1.067)+(3.026), (I-746)+(1.067)+(3.027), (I-746)+(1.067)+(3.028), (I-746)+(1.067)+(3.029), (I-746)+(1.067)+(3.030), (I-746)+(1.067)+(3.031), (I-746)+(1.067)+(5.001), (I-746)+(1.067)+(5.002), (I-746)+(1.067)+(5.003), (I-746)+(1.067)+(5.004), (I-746)+(1.067)+(5.005), (I-746)+(1.067)+(5.006), (I-746)+(1.067)+(5.007), (I-746)+(1.067)+(5.008), (I-746)+(1.067)+(5.009), (I-746)+(1.067)+(5.010), (I-746)+(1.067)+(5.011), (I-746)+(1.067)+(5.012), (I-746)+(1.067)+(5.013), (I-746)+(1.067)+(5.014), (I-746)+(1.067)+(5.015), (I-746)+(1.067)+(5.016), (I-746)+(1.067)+(5.017), (I-746)+(1.067)+(5.018), (I-746)+(1.067)+(5.019), (I-746)+(1.067)+(5.020), (I-746)+(1.067)+(5.021), (I-746)+(1.067)+(5.022), (I-746)+(1.067)+(5.023), (I-746)+(1.067)+(6.001), (I-746)+(1.067)+(6.002), (I-746)+(1.067)+(6.003), (I-746)+(1.067)+(6.004), (I-746)+(1.067)+(7.001), (I-746)+(1.067)+(7.002), (I-746)+(1.067)+(7.003), (I-746)+(1.067)+(7.004), (I-746)+(1.067)+(7.005), (I-746)+(1.067)+(7.006), (I-746)+(1.067)+(9.001), (I-746)+(1.067)+(9.002), (I-746)+(1.067)+(9.003), (I-746)+(1.067)+(9.004), (I-746)+(1.067)+(9.005), (I-746)+(1.067)+(9.006), (I-746)+(1.067)+(9.007), (I-746)+(1.067)+(9.008), (I-746)+(1.067)+(9.009), (I-746)+(1.067)+(14.001), (I-746)+(1.067)+(14.002), (I-746)+(1.067)+(15.008), (I-746)+(1.067)+(15.011), (I-746)+(1.067)+(15.012), (I-746)+(1.067)+(15.016), (I-746)+(1.067)+(15.025), (I-746)+(1.067)+(15.027), (I-746)+(1.067)+(15.047), (I-746)+(1.067)+(15.063), (I-746)+(1.067)+(15.064), (I-746)+(1.067)+(16.001), (I-746)+(1.067)+(16.002), (I-746)+(1.067)+(16.003), (I-746)+(1.067)+(16.004), (I-746)+(1.067)+(16.005), (I-746)+(1.067)+(16.006), (I-746)+(1.067)+(16.007), (I-746)+(1.067)+(16.008), (I-746)+(1.067)+(17.001), (I-746)+(1.067)+(17.002), (I-746)+(1.067)+(17.003), (I-746)+(1.067)+(17.004), (I-746)+(1.067)+(17.005), (I-746)+(1.067)+(17.006), (I-746)+(1.067)+(17.007), (I-746)+(1.067)+(17.008), (I-746)+(1.067)+(17.009), (I-746)+(1.067)+(17.010), (I-746)+(1.067)+(17.011), (I-746)+(1.067)+(17.012), (I-746)+(1.067)+(18.001),

(I-746)+(1.068)+(1.069), (I-746)+(1.068)+(1.070), (I-746)+(1.068)+(1.071), (I-746)+(1.068)+(1.072), (I-746)+(1.068)+(1.073), (I-746)+(1.068)+(1.074), (I-746)+(1.068)+(1.075), (I-746)+(1.068)+(1.076), (I-746)+(1.068)+(1.077), (I-746)+(1.068)+(1.078), (I-746)+(1.068)+(1.079), (I-746)+(1.068)+(1.080), (I-746)+(1.068)+(1.081), (I-746)+(1.068)+(1.082), (I-746)+(1.068)+(1.083), (I-746)+(1.068)+(1.084), (I-746)+(1.068)+(1.085), (I-746)+(1.068)+(1.086), (I-746)+(1.068)+(1.087), (I-746)+(1.068)+(1.088), (I-746)+(1.068)+(1.089), (I-746)+(1.068)+(1.090), (I-746)+(1.068)+(1.091), (I-746)+(1.068)+(1.092), (I-746)+(1.068)+(2.001), (I-746)+(1.068)+(2.002), (I-746)+(1.068)+(2.003), (I-746)+(1.068)+(2.004), (I-746)+(1.068)+(2.005), (I-746)+(1.068)+(2.006), (I-746)+(1.068)+(2.007), (I-746)+(1.068)+(2.008), (I-746)+(1.068)+(2.009), (I-746)+(1.068)+(2.010), (I-746)+(1.068)+(2.011), (I-746)+(1.068)+(2.012), (I-746)+(1.068)+(2.013), (I-746)+(1.068)+(2.014), (I-746)+(1.068)+(2.015), (I-746)+(1.068)+(2.016), (I-746)+(1.068)+(2.017), (I-746)+(1.068)+(2.018), (I-746)+(1.068)+(2.019), (I-746)+(1.068)+(2.020), (I-746)+(1.068)+(2.021), (I-746)+(1.068)+(2.022), (I-746)+(1.068)+(2.023), (I-746)+(1.068)+(2.024), (I-746)+(1.068)+(2.025), (I-746)+(1.068)+(2.026), (I-746)+(1.068)+(2.027), (I-746)+(1.068)+(2.028), (I-746)+(1.068)+(2.029), (I-746)+(1.068)+(2.030), (I-746)+(1.068)+(2.031), (I-746)+(1.068)+(2.032), (I-746)+(1.068)+(2.033), (I-746)+(1.068)+(2.034), (I-746)+(1.068)+(2.035), (I-746)+(1.068)+(2.036), (I-746)+(1.068)+(2.037), (I-746)+(1.068)+(2.038), (I-746)+(1.068)+(2.039), (I-746)+(1.068)+(2.040), (I-746)+(1.068)+(2.041), (I-746)+(1.068)+(2.042), (I-746)+(1.068)+(2.043), (I-746)+(1.068)+(2.044), (I-746)+(1.068)+(2.045), (I-746)+(1.068)+(2.046), (I-746)+(1.068)+(2.047), (I-746)+(1.068)+(2.048), (I-746)+(1.068)+(2.049), (I-746)+(1.068)+(2.050), (I-746)+(1.068)+(2.051), (I-746)+(1.068)+(2.052), (I-746)+(1.068)+(2.053), (I-746)+(1.068)+(2.054), (I-746)+(1.068)+(2.055), (I-746)+(1.068)+(2.056), (I-746)+(1.068)+(2.057), (I-746)+(1.068)+(2.058), (I-746)+(1.068)+(2.059), (I-746)+(1.068)+(3.001), (I-746)+(1.068)+(3.002), (I-746)+(1.068)+(3.003), (I-746)+(1.068)+(3.004), (I-746)+(1.068)+(3.005), (I-746)+(1.068)+(3.006), (I-746)+(1.068)+(3.007), (I-746)+(1.068)+(3.008), (I-746)+(1.068)+(3.009), (I-746)+(1.068)+(3.010), (I-746)+(1.068)+(3.011), (I-746)+(1.068)+(3.012), (I-746)+(1.068)+(3.013), (I-746)+(1.068)+(3.014), (I-746)+(1.068)+(3.015), (I-746)+(1.068)+(3.016), (I-746)+(1.068)+(3.017), (I-746)+(1.068)+(3.018), (I-746)+(1.068)+(3.019), (I-746)+(1.068)+(3.020), (I-746)+(1.068)+(3.021), (I-746)+(1.068)+(3.022), (I-746)+(1.068)+(3.023), (I-746)+(1.068)+(3.024), (I-746)+(1.068)+(3.025), (I-746)+(1.068)+(3.026), (I-746)+(1.068)+(3.027), (I-746)+(1.068)+(3.028), (I-746)+(1.068)+(3.029), (I-746)+(1.068)+(3.030), (I-746)+(1.068)+(3.031), (I-746)+(1.068)+(5.001), (I-746)+(1.068)+(5.002), (I-746)+(1.068)+(5.003), (I-746)+(1.068)+(5.004), (I-746)+(1.068)+(5.005), (I-746)+(1.068)+(5.006), (I-746)+(1.068)+(5.007), (I-746)+(1.068)+(5.008), (I-746)+(1.068)+(5.009), (I-746)+(1.068)+(5.010), (I-746)+(1.068)+(5.011), (I-746)+(1.068)+(5.012), (I-746)+(1.068)+(5.013), (I-746)+(1.068)+(5.014), (I-746)+(1.068)+(5.015), (I-746)+(1.068)+(5.016), (I-746)+(1.068)+(5.017), (I-746)+(1.068)+(5.018), (I-746)+(1.068)+(5.019), (I-746)+(1.068)+(5.020), (I-746)+(1.068)+(5.021), (I-746)+(1.068)+(5.022), (I-746)+(1.068)+(5.023), (I-746)+(1.068)+(6.001), (I-746)+(1.068)+(6.002), (I-746)+(1.068)+(6.003), (I-746)+(1.068)+(6.004), (I-746)+(1.068)+(7.001), (I-746)+(1.068)+(7.002), (I-746)+(1.068)+(7.003), (I-746)+(1.068)+(7.004), (I-746)+(1.068)+(7.005), (I-746)+(1.068)+(7.006), (I-746)+(1.068)+(9.001), (I-746)+(1.068)+(9.002), (I-746)+(1.068)+(9.003), (I-746)+(1.068)+(9.004), (I-746)+(1.068)+(9.005), (I-746)+(1.068)+(9.006), (I-746)+(1.068)+(9.007), (I-746)+(1.068)+(9.008), (I-746)+(1.068)+(9.009), (I-746)+(1.068)+(14.001), (I-746)+(1.068)+(14.002), (I-746)+(1.068)+(15.008), (I-746)+(1.068)+(15.011), (I-746)+(1.068)+(15.012), (I-746)+(1.068)+(15.016), (I-746)+(1.068)+(15.025), (I-746)+(1.068)+(15.027), (I-746)+(1.068)+(15.047), (I-746)+(1.068)+(15.063), (I-746)+(1.068)+(15.064), (I-746)+(1.068)+(16.001), (I-746)+(1.068)+(16.002), (I-746)+(1.068)+(16.003), (I-746)+(1.068)+(16.004), (I-746)+(1.068)+(16.005), (I-746)+(1.068)+(16.006), (I-746)+(1.068)+(16.007), (I-746)+(1.068)+(16.008), (I-746)+(1.068)+(17.001), (I-746)+(1.068)+(17.002), (I-746)+(1.068)+(17.003), (I-746)+(1.068)+(17.004), (I-746)+(1.068)+(17.005), (I-746)+(1.068)+(17.006), (I-746)+(1.068)+(17.007), (I-746)+(1.068)+(17.008), (I-746)+(1.068)+(17.009), (I-746)+(1.068)+(17.010), (I-746)+(1.068)+(17.011), (I-746)+(1.068)+(17.012), (I-746)+(1.068)+(18.001),

(I-746)+(1.069)+(1.070), (I-746)+(1.069)+(1.071), (I-746)+(1.069)+(1.072), (I-746)+(1.069)+(1.073), (I-746)+(1.069)+(1.074), (I-746)+(1.069)+(1.075), (I-746)+(1.069)+(1.076), (I-746)+(1.069)+(1.077), (I-746)+(1.069)+(1.078), (I-746)+(1.069)+(1.079), (I-746)+(1.069)+(1.080), (I-746)+(1.069)+(1.081), (I-746)+(1.069)+(1.082), (I-746)+(1.069)+(1.083), (I-746)+(1.069)+(1.084), (I-746)+(1.069)+(1.085), (I-746)+(1.069)+(1.086), (I-746)+(1.069)+(1.087), (I-746)+(1.069)+(1.088), (I-746)+(1.069)+(1.089), (I-746)+(1.069)+(1.090), (I-746)+(1.069)+(1.091), (I-746)+(1.069)+(1.092), (I-746)+(1.069)+(2.001), (I-746)+(1.069)+(2.002), (I-746)+(1.069)+(2.003), (I-746)+(1.069)+(2.004), (I-746)+(1.069)+(2.005), (I-746)+(1.069)+(2.006), (I-746)+(1.069)+(2.007), (I-746)+(1.069)+(2.008), (I-746)+(1.069)+(2.009), (I-746)+(1.069)+(2.010), (I-746)+(1.069)+(2.011), (I-746)+(1.069)+(2.012), (I-746)+(1.069)+(2.013), (I-746)+(1.069)+(2.014), (I-746)+(1.069)+(2.015), (I-746)+(1.069)+(2.016), (I-746)+(1.069)+(2.017), (I-746)+(1.069)+(2.018), (I-746)+(1.069)+(2.019), (I-746)+(1.069)+(2.020), (I-746)+(1.069)+(2.021), (I-746)+(1.069)+(2.022), (I-746)+(1.069)+(2.023), (I-746)+(1.069)+(2.024), (I-746)+(1.069)+(2.025), (I-746)+(1.069)+(2.026), (I-746)+(1.069)+(2.027), (I-746)+(1.069)+(2.028), (I-746)+(1.069)+(2.029), (I-746)+(1.069)+(2.030), (I-746)+(1.069)+(2.031), (I-746)+(1.069)+(2.032), (I-746)+(1.069)+(2.033), (I-746)+(1.069)+(2.034), (I-746)+(1.069)+(2.035), (I-746)+(1.069)+(2.036), (I-746)+(1.069)+(2.037), (I-746)+(1.069)+(2.038), (I-746)+(1.069)+(2.039), (I-746)+(1.069)+(2.040), (I-746)+(1.069)+(2.041), (I-746)+(1.069)+(2.042), (I-746)+(1.069)+(2.043), (I-746)+(1.069)+(2.044), (I-746)+(1.069)+(2.045), (I-746)+(1.069)+(2.046), (I-746)+(1.069)+(2.047), (I-746)+(1.069)+(2.048), (I-746)+(1.069)+(2.049), (I-746)+(1.069)+(2.050), (I-746)+(1.069)+(2.051), (I-746)+(1.069)+(2.052), (I-746)+(1.069)+(2.053), (I-746)+(1.069)+(2.054), (I-746)+(1.069)+(2.055), (I-746)+(1.069)+(2.056), (I-746)+(1.069)+(2.057), (I-746)+(1.069)+(2.058), (I-746)+(1.069)+(2.059), (I-746)+(1.069)+(3.001), (I-746)+(1.069)+(3.002), (I-746)+(1.069)+(3.003), (I-746)+(1.069)+(3.004), (I-746)+(1.069)+(3.005), (I-746)+(1.069)+(3.006), (I-746)+(1.069)+(3.007), (I-746)+(1.069)+(3.008), (I-746)+(1.069)+(3.009), (I-746)+(1.069)+(3.010), (I-746)+(1.069)+(3.011), (I-746)+(1.069)+(3.012), (I-746)+(1.069)+(3.013), (I-746)+(1.069)+(3.014), (I-746)+(1.069)+(3.015), (I-746)+(1.069)+(3.016), (I-746)+(1.069)+(3.017), (I-746)+(1.069)+(3.018), (I-746)+(1.069)+(3.019), (I-746)+(1.069)+(3.020), (I-746)+(1.069)+(3.021), (I-746)+(1.069)+(3.022), (I-746)+(1.069)+(3.023), (I-746)+(1.069)+(3.024), (I-746)+(1.069)+(3.025), (I-746)+(1.069)+(3.026), (I-746)+(1.069)+(3.027), (I-746)+(1.069)+(3.028), (I-746)+(1.069)+(3.029), (I-746)+(1.069)+(3.030), (I-746)+(1.069)+(3.031), (I-746)+(1.069)+(5.001), (I-746)+(1.069)+(5.002), (I-746)+(1.069)+(5.003), (I-746)+(1.069)+(5.004), (I-746)+(1.069)+(5.005), (I-746)+(1.069)+(5.006), (I-746)+(1.069)+(5.007), (I-746)+(1.069)+(5.008), (I-746)+(1.069)+(5.009), (I-746)+(1.069)+(5.010), (I-746)+(1.069)+(5.011), (I-746)+(1.069)+(5.012), (I-746)+(1.069)+(5.013), (I-746)+(1.069)+(5.014), (I-746)+(1.069)+(5.015), (I-746)+(1.069)+(5.016), (I-746)+(1.069)+(5.017), (I-746)+(1.069)+(5.018), (I-746)+(1.069)+(5.019), (I-746)+(1.069)+(5.020), (I-746)+(1.069)+(5.021), (I-746)+(1.069)+(5.022), (I-746)+(1.069)+(5.023), (I-746)+(1.069)+(6.001), (I-746)+(1.069)+(6.002), (I-746)+(1.069)+(6.003), (I-746)+(1.069)+(6.004), (I-746)+(1.069)+(7.001), (I-746)+(1.069)+(7.002), (I-746)+(1.069)+(7.003), (I-746)+(1.069)+(7.004), (I-746)+(1.069)+(7.005), (I-746)+(1.069)+(7.006), (I-746)+(1.069)+(9.001), (I-746)+(1.069)+(9.002), (I-746)+(1.069)+(9.003), (I-746)+(1.069)+(9.004), (I-746)+(1.069)+(9.005), (I-746)+(1.069)+(9.006), (I-746)+(1.069)+(9.007), (I-746)+(1.069)+(9.008), (I-746)+(1.069)+(9.009), (I-746)+(1.069)+(14.001), (I-746)+(1.069)+(14.002), (I-746)+(1.069)+(15.008), (I-746)+(1.069)+(15.011), (I-746)+(1.069)+(15.012), (I-746)+(1.069)+(15.016), (I-746)+(1.069)+(15.025), (I-746)+(1.069)+(15.027), (I-746)+(1.069)+(15.047), (I-746)+(1.069)+(15.063), (I-746)+(1.069)+(15.064), (I-746)+(1.069)+(16.001), (I-746)+(1.069)+(16.002), (I-746)+(1.069)+(16.003), (I-746)+(1.069)+(16.004), (I-746)+(1.069)+(16.005), (I-746)+(1.069)+(16.006), (I-746)+(1.069)+(16.007), (I-746)+(1.069)+(16.008), (I-746)+(1.069)+(17.001), (I-746)+(1.069)+(17.002), (I-746)+(1.069)+(17.003), (I-746)+(1.069)+(17.004), (I-746)+(1.069)+(17.005), (I-746)+(1.069)+(17.006), (I-746)+(1.069)+(17.007), (I-746)+(1.069)+(17.008), (I-746)+(1.069)+(17.009), (I-746)+(1.069)+(17.010), (I-746)+(1.069)+(17.011), (I-746)+(1.069)+(17.012), (I-746)+(1.069)+(18.001),

(I-746)+(1.070)+(1.071), (I-746)+(1.070)+(1.072), (I-746)+(1.070)+(1.073), (I-746)+(1.070)+(1.074), (I-746)+(1.070)+(1.075), (I-746)+(1.070)+(1.076), (I-746)+(1.070)+(1.077), (I-746)+(1.070)+(1.078), (I-746)+(1.070)+(1.079), (I-746)+(1.070)+(1.080), (I-746)+(1.070)+(1.081), (I-746)+(1.070)+(1.082), (I-746)+(1.070)+(1.083), (I-746)+(1.070)+(1.084), (I-746)+(1.070)+(1.085), (I-746)+(1.070)+(1.086), (I-746)+(1.070)+(1.087), (I-746)+(1.070)+(1.088), (I-746)+(1.070)+(1.089), (I-746)+(1.070)+(1.090), (I-746)+(1.070)+(1.091), (I-746)+(1.070)+(1.092), (I-746)+(1.070)+(2.001), (I-746)+(1.070)+(2.002), (I-746)+(1.070)+(2.003), (I-746)+(1.070)+(2.004), (I-746)+(1.070)+(2.005), (I-746)+(1.070)+(2.006), (I-746)+(1.070)+(2.007), (I-746)+(1.070)+(2.008), (I-746)+(1.070)+(2.009), (I-746)+(1.070)+(2.010), (I-746)+(1.070)+(2.011), (I-746)+(1.070)+(2.012), (I-746)+(1.070)+(2.013), (I-746)+(1.070)+(2.014), (I-746)+(1.070)+(2.015), (I-746)+(1.070)+(2.016), (I-746)+(1.070)+(2.017), (I-746)+(1.070)+(2.018), (I-746)+(1.070)+(2.019), (I-746)+(1.070)+(2.020), (I-746)+(1.070)+(2.021), (I-746)+(1.070)+(2.022), (I-746)+(1.070)+(2.023), (I-746)+(1.070)+(2.024), (I-746)+(1.070)+(2.025), (I-746)+(1.070)+(2.026), (I-746)+(1.070)+(2.027), (I-746)+(1.070)+(2.028), (I-746)+(1.070)+(2.029), (I-746)+(1.070)+(2.030), (I-746)+(1.070)+(2.031), (I-746)+(1.070)+(2.032), (I-746)+(1.070)+(2.033), (I-746)+(1.070)+(2.034), (I-746)+(1.070)+(2.035), (I-746)+(1.070)+(2.036), (I-746)+(1.070)+(2.037), (I-746)+(1.070)+(2.038), (I-746)+(1.070)+(2.039), (I-746)+(1.070)+(2.040), (I-746)+(1.070)+(2.041), (I-746)+(1.070)+(2.042), (I-746)+(1.070)+(2.043), (I-746)+(1.070)+(2.044), (I-746)+(1.070)+(2.045), (I-746)+(1.070)+(2.046), (I-746)+(1.070)+(2.047), (I-746)+(1.070)+(2.048), (I-746)+(1.070)+(2.049), (I-746)+(1.070)+(2.050), (I-746)+(1.070)+(2.051), (I-746)+(1.070)+(2.052), (I-746)+(1.070)+(2.053), (I-746)+(1.070)+(2.054), (I-746)+(1.070)+(2.055), (I-746)+(1.070)+(2.056), (I-746)+(1.070)+(2.057), (I-746)+(1.070)+(2.058), (I-746)+(1.070)+(2.059), (I-746)+(1.070)+(3.001), (I-746)+(1.070)+(3.002), (I-746)+(1.070)+(3.003), (I-746)+(1.070)+(3.004), (I-746)+(1.070)+(3.005), (I-746)+(1.070)+(3.006), (I-746)+(1.070)+(3.007), (I-746)+(1.070)+(3.008), (I-746)+(1.070)+(3.009), (I-746)+(1.070)+(3.010), (I-746)+(1.070)+(3.011), (I-746)+(1.070)+(3.012), (I-746)+(1.070)+(3.013), (I-746)+(1.070)+(3.014), (I-746)+(1.070)+(3.015), (I-746)+(1.070)+(3.016), (I-746)+(1.070)+(3.017), (I-746)+(1.070)+(3.018), (I-746)+(1.070)+(3.019), (I-746)+(1.070)+(3.020), (I-746)+(1.070)+(3.021), (I-746)+(1.070)+(3.022), (I-746)+(1.070)+(3.023), (I-746)+(1.070)+(3.024), (I-746)+(1.070)+(3.025), (I-746)+(1.070)+(3.026), (I-746)+(1.070)+(3.027), (I-746)+(1.070)+(3.028), (I-746)+(1.070)+(3.029), (I-746)+(1.070)+(3.030), (I-746)+(1.070)+(3.031), (I-746)+(1.070)+(5.001), (I-746)+(1.070)+(5.002), (I-746)+(1.070)+(5.003), (I-746)+(1.070)+(5.004), (I-746)+(1.070)+(5.005), (I-746)+(1.070)+(5.006), (I-746)+(1.070)+(5.007), (I-746)+(1.070)+(5.008), (I-746)+(1.070)+(5.009), (I-746)+(1.070)+(5.010), (I-746)+(1.070)+(5.011), (I-746)+(1.070)+(5.012), (I-746)+(1.070)+(5.013), (I-746)+(1.070)+(5.014), (I-746)+(1.070)+(5.015), (I-746)+(1.070)+(5.016), (I-746)+(1.070)+(5.017), (I-746)+(1.070)+(5.018), (I-746)+(1.070)+(5.019), (I-746)+(1.070)+(5.020), (I-746)+(1.070)+(5.021), (I-746)+(1.070)+(5.022), (I-746)+(1.070)+(5.023), (I-746)+(1.070)+(6.001), (I-746)+(1.070)+(6.002), (I-746)+(1.070)+(6.003), (I-746)+(1.070)+(6.004), (I-746)+(1.070)+(7.001), (I-746)+(1.070)+(7.002), (I-746)+(1.070)+(7.003), (I-746)+(1.070)+(7.004), (I-746)+(1.070)+(7.005), (I-746)+(1.070)+(7.006), (I-746)+(1.070)+(9.001), (I-746)+(1.070)+(9.002), (I-746)+(1.070)+(9.003), (I-746)+(1.070)+(9.004), (I-746)+(1.070)+(9.005), (I-746)+(1.070)+(9.006), (I-746)+(1.070)+(9.007), (I-746)+(1.070)+(9.008), (I-746)+(1.070)+(9.009), (I-746)+(1.070)+(14.001), (I-746)+(1.070)+(14.002), (I-746)+(1.070)+(15.008), (I-746)+(1.070)+(15.011), (I-746)+(1.070)+(15.012), (I-746)+(1.070)+(15.016), (I-746)+(1.070)+(15.025), (I-746)+(1.070)+(15.027), (I-746)+(1.070)+(15.047), (I-746)+(1.070)+(15.063), (I-746)+(1.070)+(15.064), (I-746)+(1.070)+(16.001), (I-746)+(1.070)+(16.002), (I-746)+(1.070)+(16.003), (I-746)+(1.070)+(16.004), (I-746)+(1.070)+(16.005), (I-746)+(1.070)+(16.006), (I-746)+(1.070)+(16.007), (I-746)+(1.070)+(16.008), (I-746)+(1.070)+(17.001), (I-746)+(1.070)+(17.002), (I-746)+(1.070)+(17.003), (I-746)+(1.070)+(17.004), (I-746)+(1.070)+(17.005), (I-746)+(1.070)+(17.006), (I-746)+(1.070)+(17.007), (I-746)+(1.070)+(17.008), (I-746)+(1.070)+(17.009), (I-746)+(1.070)+(17.010), (I-746)+(1.070)+(17.011), (I-746)+(1.070)+(17.012), (I-746)+(1.070)+(18.001),

(I-746)+(1.071)+(1.072), (I-746)+(1.071)+(1.073), (I-746)+(1.071)+(1.074), (I-746)+(1.071)+(1.075), (I-746)+(1.071)+(1.076), (I-746)+(1.071)+(1.077), (I-746)+(1.071)+(1.078), (I-746)+(1.071)+(1.079), (I-746)+(1.071)+(1.080), (I-746)+(1.071)+(1.081), (I-746)+(1.071)+(1.082), (I-746)+(1.071)+(1.083), (I-746)+(1.071)+(1.084), (I-746)+(1.071)+(1.085), (I-746)+(1.071)+(1.086), (I-746)+(1.071)+(1.087), (I-746)+(1.071)+(1.088), (I-746)+(1.071)+(1.089), (I-746)+(1.071)+(1.090), (I-746)+(1.071)+(1.091), (I-746)+(1.071)+(1.092), (I-746)+(1.071)+(2.001), (I-746)+(1.071)+(2.002), (I-746)+(1.071)+(2.003), (I-746)+(1.071)+(2.004), (I-746)+(1.071)+(2.005), (I-746)+(1.071)+(2.006), (I-746)+(1.071)+(2.007), (I-746)+(1.071)+(2.008), (I-746)+(1.071)+(2.009), (I-746)+(1.071)+(2.010), (I-746)+(1.071)+(2.011), (I-746)+(1.071)+(2.012), (I-746)+(1.071)+(2.013), (I-746)+(1.071)+(2.014), (I-746)+(1.071)+(2.015), (I-746)+(1.071)+(2.016), (I-746)+(1.071)+(2.017), (I-746)+(1.071)+(2.018), (I-746)+(1.071)+(2.019), (I-746)+(1.071)+(2.020), (I-746)+(1.071)+(2.021), (I-746)+(1.071)+(2.022), (I-746)+(1.071)+(2.023), (I-746)+(1.071)+(2.024), (I-746)+(1.071)+(2.025), (I-746)+(1.071)+(2.026), (I-746)+(1.071)+(2.027), (I-746)+(1.071)+(2.028), (I-746)+(1.071)+(2.029), (I-746)+(1.071)+(2.030), (I-746)+(1.071)+(2.031), (I-746)+(1.071)+(2.032), (I-746)+(1.071)+(2.033), (I-746)+(1.071)+(2.034), (I-746)+(1.071)+(2.035), (I-746)+(1.071)+(2.036), (I-746)+(1.071)+(2.037), (I-746)+(1.071)+(2.038), (I-746)+(1.071)+(2.039), (I-746)+(1.071)+(2.040), (I-746)+(1.071)+(2.041), (I-746)+(1.071)+(2.042), (I-746)+(1.071)+(2.043), (I-746)+(1.071)+(2.044), (I-746)+(1.071)+(2.045), (I-746)+(1.071)+(2.046), (I-746)+(1.071)+(2.047), (I-746)+(1.071)+(2.048), (I-746)+(1.071)+(2.049), (I-746)+(1.071)+(2.050), (I-746)+(1.071)+(2.051), (I-746)+(1.071)+(2.052), (I-746)+(1.071)+(2.053), (I-746)+(1.071)+(2.054), (I-746)+(1.071)+(2.055), (I-746)+(1.071)+(2.056), (I-746)+(1.071)+(2.057), (I-746)+(1.071)+(2.058), (I-746)+(1.071)+(2.059), (I-746)+(1.071)+(3.001), (I-746)+(1.071)+(3.002), (I-746)+(1.071)+(3.003), (I-746)+(1.071)+(3.004), (I-746)+(1.071)+(3.005), (I-746)+(1.071)+(3.006), (I-746)+(1.071)+(3.007), (I-746)+(1.071)+(3.008), (I-746)+(1.071)+(3.009), (I-746)+(1.071)+(3.010), (I-746)+(1.071)+(3.011), (I-746)+(1.071)+(3.012), (I-746)+(1.071)+(3.013), (I-746)+(1.071)+(3.014), (I-746)+(1.071)+(3.015), (I-746)+(1.071)+(3.016), (I-746)+(1.071)+(3.017), (I-746)+(1.071)+(3.018), (I-746)+(1.071)+(3.019), (I-746)+(1.071)+(3.020), (I-746)+(1.071)+(3.021), (I-746)+(1.071)+(3.022), (I-746)+(1.071)+(3.023), (I-746)+(1.071)+(3.024), (I-746)+(1.071)+(3.025), (I-746)+(1.071)+(3.026), (I-746)+(1.071)+(3.027), (I-746)+(1.071)+(3.028), (I-746)+(1.071)+(3.029), (I-746)+(1.071)+(3.030), (I-746)+(1.071)+(3.031), (I-746)+(1.071)+(5.001), (I-746)+(1.071)+(5.002), (I-746)+(1.071)+(5.003), (I-746)+(1.071)+(5.004), (I-746)+(1.071)+(5.005), (I-746)+(1.071)+(5.006), (I-746)+(1.071)+(5.007), (I-746)+(1.071)+(5.008), (I-746)+(1.071)+(5.009), (I-746)+(1.071)+(5.010), (I-746)+(1.071)+(5.011), (I-746)+(1.071)+(5.012), (I-746)+(1.071)+(5.013), (I-746)+(1.071)+(5.014), (I-746)+(1.071)+(5.015), (I-746)+(1.071)+(5.016), (I-746)+(1.071)+(5.017), (I-746)+(1.071)+(5.018), (I-746)+(1.071)+(5.019), (I-746)+(1.071)+(5.020), (I-746)+(1.071)+(5.021), (I-746)+(1.071)+(5.022), (I-746)+(1.071)+(5.023), (I-746)+(1.071)+(6.001), (I-746)+(1.071)+(6.002), (I-746)+(1.071)+(6.003), (I-746)+(1.071)+(6.004), (I-746)+(1.071)+(7.001), (I-746)+(1.071)+(7.002), (I-746)+(1.071)+(7.003), (I-746)+(1.071)+(7.004), (I-746)+(1.071)+(7.005), (I-746)+(1.071)+(7.006), (I-746)+(1.071)+(9.001), (I-746)+(1.071)+(9.002), (I-746)+(1.071)+(9.003), (I-746)+(1.071)+(9.004), (I-746)+(1.071)+(9.005), (I-746)+(1.071)+(9.006), (I-746)+(1.071)+(9.007), (I-746)+(1.071)+(9.008), (I-746)+(1.071)+(9.009), (I-746)+(1.071)+(14.001), (I-746)+(1.071)+(14.002), (I-746)+(1.071)+(15.008), (I-746)+(1.071)+(15.011), (I-746)+(1.071)+(15.012), (I-746)+(1.071)+(15.016), (I-746)+(1.071)+(15.025), (I-746)+(1.071)+(15.027), (I-746)+(1.071)+(15.047), (I-746)+(1.071)+(15.063), (I-746)+(1.071)+(15.064), (I-746)+(1.071)+(16.001), (I-746)+(1.071)+(16.002), (I-746)+(1.071)+(16.003), (I-746)+(1.071)+(16.004), (I-746)+(1.071)+(16.005), (I-746)+(1.071)+(16.006), (I-746)+(1.071)+(16.007), (I-746)+(1.071)+(16.008), (I-746)+(1.071)+(17.001), (I-746)+(1.071)+(17.002), (I-746)+(1.071)+(17.003), (I-746)+(1.071)+(17.004), (I-746)+(1.071)+(17.005), (I-746)+(1.071)+(17.006), (I-746)+(1.071)+(17.007), (I-746)+(1.071)+(17.008), (I-746)+(1.071)+(17.009), (I-746)+(1.071)+(17.010), (I-746)+(1.071)+(17.011), (I-746)+(1.071)+(17.012), (I-746)+(1.071)+(18.001),

(I-746)+(1.072)+(1.073), (I-746)+(1.072)+(1.074), (I-746)+(1.072)+(1.075), (I-746)+(1.072)+(1.076), (I-746)+(1.072)+(1.077), (I-746)+(1.072)+(1.078), (I-746)+(1.072)+(1.079), (I-746)+(1.072)+(1.080), (I-746)+(1.072)+(1.081), (I-746)+(1.072)+(1.082), (I-746)+(1.072)+(1.083), (I-746)+(1.072)+(1.084), (I-746)+(1.072)+(1.085), (I-746)+(1.072)+(1.086), (I-746)+(1.072)+(1.087), (I-746)+(1.072)+(1.088), (I-746)+(1.072)+(1.089), (I-746)+(1.072)+(1.090), (I-746)+(1.072)+(1.091), (I-746)+(1.072)+(1.092), (I-746)+(1.072)+(2.001), (I-746)+(1.072)+(2.002), (I-746)+(1.072)+(2.003), (I-746)+(1.072)+(2.004), (I-746)+(1.072)+(2.005), (I-746)+(1.072)+(2.006), (I-746)+(1.072)+(2.007), (I-746)+(1.072)+(2.008), (I-746)+(1.072)+(2.009), (I-746)+(1.072)+(2.010), (I-746)+(1.072)+(2.011), (I-746)+(1.072)+(2.012), (I-746)+(1.072)+(2.013), (I-746)+(1.072)+(2.014), (I-746)+(1.072)+(2.015), (I-746)+(1.072)+(2.016), (I-746)+(1.072)+(2.017), (I-746)+(1.072)+(2.018), (I-746)+(1.072)+(2.019), (I-746)+(1.072)+(2.020), (I-746)+(1.072)+(2.021), (I-746)+(1.072)+(2.022), (I-746)+(1.072)+(2.023), (I-746)+(1.072)+(2.024), (I-746)+(1.072)+(2.025), (I-746)+(1.072)+(2.026), (I-746)+(1.072)+(2.027), (I-746)+(1.072)+(2.028), (I-746)+(1.072)+(2.029), (I-746)+(1.072)+(2.030), (I-746)+(1.072)+(2.031), (I-746)+(1.072)+(2.032), (I-746)+(1.072)+(2.033), (I-746)+(1.072)+(2.034), (I-746)+(1.072)+(2.035), (I-746)+(1.072)+(2.036), (I-746)+(1.072)+(2.037), (I-746)+(1.072)+(2.038), (I-746)+(1.072)+(2.039), (I-746)+(1.072)+(2.040), (I-746)+(1.072)+(2.041), (I-746)+(1.072)+(2.042), (I-746)+(1.072)+(2.043), (I-746)+(1.072)+(2.044), (I-746)+(1.072)+(2.045), (I-746)+(1.072)+(2.046), (I-746)+(1.072)+(2.047), (I-746)+(1.072)+(2.048), (I-746)+(1.072)+(2.049), (I-746)+(1.072)+(2.050), (I-746)+(1.072)+(2.051), (I-746)+(1.072)+(2.052), (I-746)+(1.072)+(2.053), (I-746)+(1.072)+(2.054), (I-746)+(1.072)+(2.055), (I-746)+(1.072)+(2.056), (I-746)+(1.072)+(2.057), (I-746)+(1.072)+(2.058), (I-746)+(1.072)+(2.059), (I-746)+(1.072)+(3.001), (I-746)+(1.072)+(3.002), (I-746)+(1.072)+(3.003), (I-746)+(1.072)+(3.004), (I-746)+(1.072)+(3.005), (I-746)+(1.072)+(3.006), (I-746)+(1.072)+(3.007), (I-746)+(1.072)+(3.008), (I-746)+(1.072)+(3.009), (I-746)+(1.072)+(3.010), (I-746)+(1.072)+(3.011), (I-746)+(1.072)+(3.012), (I-746)+(1.072)+(3.013), (I-746)+(1.072)+(3.014), (I-746)+(1.072)+(3.015), (I-746)+(1.072)+(3.016), (I-746)+(1.072)+(3.017), (I-746)+(1.072)+(3.018), (I-746)+(1.072)+(3.019), (I-746)+(1.072)+(3.020), (I-746)+(1.072)+(3.021), (I-746)+(1.072)+(3.022), (I-746)+(1.072)+(3.023), (I-746)+(1.072)+(3.024), (I-746)+(1.072)+(3.025), (I-746)+(1.072)+(3.026), (I-746)+(1.072)+(3.027), (I-746)+(1.072)+(3.028), (I-746)+(1.072)+(3.029), (I-746)+(1.072)+(3.030), (I-746)+(1.072)+(3.031), (I-746)+(1.072)+(5.001), (I-746)+(1.072)+(5.002), (I-746)+(1.072)+(5.003), (I-746)+(1.072)+(5.004), (I-746)+(1.072)+(5.005), (I-746)+(1.072)+(5.006), (I-746)+(1.072)+(5.007), (I-746)+(1.072)+(5.008), (I-746)+(1.072)+(5.009), (I-746)+(1.072)+(5.010), (I-746)+(1.072)+(5.011), (I-746)+(1.072)+(5.012), (I-746)+(1.072)+(5.013), (I-746)+(1.072)+(5.014), (I-746)+(1.072)+(5.015), (I-746)+(1.072)+(5.016), (I-746)+(1.072)+(5.017), (I-746)+(1.072)+(5.018), (I-746)+(1.072)+(5.019), (I-746)+(1.072)+(5.020), (I-746)+(1.072)+(5.021), (I-746)+(1.072)+(5.022), (I-746)+(1.072)+(5.023), (I-746)+(1.072)+(6.001), (I-746)+(1.072)+(6.002), (I-746)+(1.072)+(6.003), (I-746)+(1.072)+(6.004), (I-746)+(1.072)+(7.001), (I-746)+(1.072)+(7.002), (I-746)+(1.072)+(7.003), (I-746)+(1.072)+(7.004), (I-746)+(1.072)+(7.005), (I-746)+(1.072)+(7.006), (I-746)+(1.072)+(9.001), (I-746)+(1.072)+(9.002), (I-746)+(1.072)+(9.003), (I-746)+(1.072)+(9.004), (I-746)+(1.072)+(9.005), (I-746)+(1.072)+(9.006), (I-746)+(1.072)+(9.007), (I-746)+(1.072)+(9.008), (I-746)+(1.072)+(9.009), (I-746)+(1.072)+(14.001), (I-746)+(1.072)+(14.002), (I-746)+(1.072)+(15.008), (I-746)+(1.072)+(15.011), (I-746)+(1.072)+(15.012), (I-746)+(1.072)+(15.016), (I-746)+(1.072)+(15.025), (I-746)+(1.072)+(15.027), (I-746)+(1.072)+(15.047), (I-746)+(1.072)+(15.063), (I-746)+(1.072)+(15.064), (I-746)+(1.072)+(16.001), (I-746)+(1.072)+(16.002), (I-746)+(1.072)+(16.003), (I-746)+(1.072)+(16.004), (I-746)+(1.072)+(16.005), (I-746)+(1.072)+(16.006), (I-746)+(1.072)+(16.007), (I-746)+(1.072)+(16.008), (I-746)+(1.072)+(17.001), (I-746)+(1.072)+(17.002), (I-746)+(1.072)+(17.003), (I-746)+(1.072)+(17.004), (I-746)+(1.072)+(17.005), (I-746)+(1.072)+(17.006), (I-746)+(1.072)+(17.007), (I-746)+(1.072)+(17.008), (I-746)+(1.072)+(17.009), (I-746)+(1.072)+(17.010), (I-746)+(1.072)+(17.011), (I-746)+(1.072)+(17.012), (I-746)+(1.072)+(18.001),

(I-746)+(1.073)+(1.074), (I-746)+(1.073)+(1.075), (I-746)+(1.073)+(1.076), (I-746)+(1.073)+(1.077), (I-746)+(1.073)+(1.078), (I-746)+(1.073)+(1.079), (I-746)+(1.073)+(1.080), (I-746)+(1.073)+(1.081), (I-746)+(1.073)+(1.082), (I-746)+(1.073)+(1.083), (I-746)+(1.073)+(1.084), (I-746)+(1.073)+(1.085), (I-746)+(1.073)+(1.086), (I-746)+(1.073)+(1.087), (I-746)+(1.073)+(1.088), (I-746)+(1.073)+(1.089), (I-746)+(1.073)+(1.090), (I-746)+(1.073)+(1.091), (I-746)+(1.073)+(1.092), (I-746)+(1.073)+(2.001), (I-746)+(1.073)+(2.002), (I-746)+(1.073)+(2.003), (I-746)+(1.073)+(2.004), (I-746)+(1.073)+(2.005), (I-746)+(1.073)+(2.006), (I-746)+(1.073)+(2.007), (I-746)+(1.073)+(2.008), (I-746)+(1.073)+(2.009), (I-746)+(1.073)+(2.010), (I-746)+(1.073)+(2.011), (I-746)+(1.073)+(2.012), (I-746)+(1.073)+(2.013), (I-746)+(1.073)+(2.014), (I-746)+(1.073)+(2.015), (I-746)+(1.073)+(2.016), (I-746)+(1.073)+(2.017), (I-746)+(1.073)+(2.018), (I-746)+(1.073)+(2.019), (I-746)+(1.073)+(2.020), (I-746)+(1.073)+(2.021), (I-746)+(1.073)+(2.022), (I-746)+(1.073)+(2.023), (I-746)+(1.073)+(2.024), (I-746)+(1.073)+(2.025), (I-746)+(1.073)+(2.026), (I-746)+(1.073)+(2.027), (I-746)+(1.073)+(2.028), (I-746)+(1.073)+(2.029), (I-746)+(1.073)+(2.030), (I-746)+(1.073)+(2.031), (I-746)+(1.073)+(2.032), (I-746)+(1.073)+(2.033), (I-746)+(1.073)+(2.034), (I-746)+(1.073)+(2.035), (I-746)+(1.073)+(2.036), (I-746)+(1.073)+(2.037), (I-746)+(1.073)+(2.038), (I-746)+(1.073)+(2.039), (I-746)+(1.073)+(2.040), (I-746)+(1.073)+(2.041), (I-746)+(1.073)+(2.042), (I-746)+(1.073)+(2.043), (I-746)+(1.073)+(2.044), (I-746)+(1.073)+(2.045), (I-746)+(1.073)+(2.046), (I-746)+(1.073)+(2.047), (I-746)+(1.073)+(2.048), (I-746)+(1.073)+(2.049), (I-746)+(1.073)+(2.050), (I-746)+(1.073)+(2.051), (I-746)+(1.073)+(2.052), (I-746)+(1.073)+(2.053), (I-746)+(1.073)+(2.054), (I-746)+(1.073)+(2.055), (I-746)+(1.073)+(2.056), (I-746)+(1.073)+(2.057), (I-746)+(1.073)+(2.058), (I-746)+(1.073)+(2.059), (I-746)+(1.073)+(3.001), (I-746)+(1.073)+(3.002), (I-746)+(1.073)+(3.003), (I-746)+(1.073)+(3.004), (I-746)+(1.073)+(3.005), (I-746)+(1.073)+(3.006), (I-746)+(1.073)+(3.007), (I-746)+(1.073)+(3.008), (I-746)+(1.073)+(3.009), (I-746)+(1.073)+(3.010), (I-746)+(1.073)+(3.011), (I-746)+(1.073)+(3.012), (I-746)+(1.073)+(3.013), (I-746)+(1.073)+(3.014), (I-746)+(1.073)+(3.015), (I-746)+(1.073)+(3.016), (I-746)+(1.073)+(3.017), (I-746)+(1.073)+(3.018), (I-746)+(1.073)+(3.019), (I-746)+(1.073)+(3.020), (I-746)+(1.073)+(3.021), (I-746)+(1.073)+(3.022), (I-746)+(1.073)+(3.023), (I-746)+(1.073)+(3.024), (I-746)+(1.073)+(3.025), (I-746)+(1.073)+(3.026), (I-746)+(1.073)+(3.027), (I-746)+(1.073)+(3.028), (I-746)+(1.073)+(3.029), (I-746)+(1.073)+(3.030), (I-746)+(1.073)+(3.031), (I-746)+(1.073)+(5.001), (I-746)+(1.073)+(5.002), (I-746)+(1.073)+(5.003), (I-746)+(1.073)+(5.004), (I-746)+(1.073)+(5.005), (I-746)+(1.073)+(5.006), (I-746)+(1.073)+(5.007), (I-746)+(1.073)+(5.008), (I-746)+(1.073)+(5.009), (I-746)+(1.073)+(5.010), (I-746)+(1.073)+(5.011), (I-746)+(1.073)+(5.012), (I-746)+(1.073)+(5.013), (I-746)+(1.073)+(5.014), (I-746)+(1.073)+(5.015), (I-746)+(1.073)+(5.016), (I-746)+(1.073)+(5.017), (I-746)+(1.073)+(5.018), (I-746)+(1.073)+(5.019), (I-746)+(1.073)+(5.020), (I-746)+(1.073)+(5.021), (I-746)+(1.073)+(5.022), (I-746)+(1.073)+(5.023), (I-746)+(1.073)+(6.001), (I-746)+(1.073)+(6.002), (I-746)+(1.073)+(6.003), (I-746)+(1.073)+(6.004), (I-746)+(1.073)+(7.001), (I-746)+(1.073)+(7.002), (I-746)+(1.073)+(7.003), (I-746)+(1.073)+(7.004), (I-746)+(1.073)+(7.005), (I-746)+(1.073)+(7.006), (I-746)+(1.073)+(9.001), (I-746)+(1.073)+(9.002), (I-746)+(1.073)+(9.003), (I-746)+(1.073)+(9.004), (I-746)+(1.073)+(9.005), (I-746)+(1.073)+(9.006), (I-746)+(1.073)+(9.007), (I-746)+(1.073)+(9.008), (I-746)+(1.073)+(9.009), (I-746)+(1.073)+(14.001), (I-746)+(1.073)+(14.002), (I-746)+(1.073)+(15.008), (I-746)+(1.073)+(15.011), (I-746)+(1.073)+(15.012), (I-746)+(1.073)+(15.016), (I-746)+(1.073)+(15.025), (I-746)+(1.073)+(15.027), (I-746)+(1.073)+(15.047), (I-746)+(1.073)+(15.063), (I-746)+(1.073)+(15.064), (I-746)+(1.073)+(16.001), (I-746)+(1.073)+(16.002), (I-746)+(1.073)+(16.003), (I-746)+(1.073)+(16.004), (I-746)+(1.073)+(16.005), (I-746)+(1.073)+(16.006), (I-746)+(1.073)+(16.007), (I-746)+(1.073)+(16.008), (I-746)+(1.073)+(17.001), (I-746)+(1.073)+(17.002), (I-746)+(1.073)+(17.003), (I-746)+(1.073)+(17.004), (I-746)+(1.073)+(17.005), (I-746)+(1.073)+(17.006), (I-746)+(1.073)+(17.007), (I-746)+(1.073)+(17.008), (I-746)+(1.073)+(17.009), (I-746)+(1.073)+(17.010), (I-746)+(1.073)+(17.011), (I-746)+(1.073)+(17.012), (I-746)+(1.073)+(18.001),

(I-746)+(1.074)+(1.075), (I-746)+(1.074)+(1.076), (I-746)+(1.074)+(1.077), (I-746)+(1.074)+(1.078), (I-746)+(1.074)+(1.079), (I-746)+(1.074)+(1.080), (I-746)+(1.074)+(1.081), (I-746)+(1.074)+(1.082), (I-746)+(1.074)+(1.083), (I-746)+(1.074)+(1.084), (I-746)+(1.074)+(1.085), (I-746)+(1.074)+(1.086), (I-746)+(1.074)+(1.087), (I-746)+(1.074)+(1.088), (I-746)+(1.074)+(1.089), (I-746)+(1.074)+(1.090), (I-746)+(1.074)+(1.091), (I-746)+(1.074)+(1.092), (I-746)+(1.074)+(2.001), (I-746)+(1.074)+(2.002), (I-746)+(1.074)+(2.003), (I-746)+(1.074)+(2.004), (I-746)+(1.074)+(2.005), (I-746)+(1.074)+(2.006), (I-746)+(1.074)+(2.007), (I-746)+(1.074)+(2.008), (I-746)+(1.074)+(2.009), (I-746)+(1.074)+(2.010), (I-746)+(1.074)+(2.011), (I-746)+(1.074)+(2.012), (I-746)+(1.074)+(2.013), (I-746)+(1.074)+(2.014), (I-746)+(1.074)+(2.015), (I-746)+(1.074)+(2.016), (I-746)+(1.074)+(2.017), (I-746)+(1.074)+(2.018), (I-746)+(1.074)+(2.019), (I-746)+(1.074)+(2.020), (I-746)+(1.074)+(2.021), (I-746)+(1.074)+(2.022), (I-746)+(1.074)+(2.023), (I-746)+(1.074)+(2.024), (I-746)+(1.074)+(2.025), (I-746)+(1.074)+(2.026), (I-746)+(1.074)+(2.027), (I-746)+(1.074)+(2.028), (I-746)+(1.074)+(2.029), (I-746)+(1.074)+(2.030), (I-746)+(1.074)+(2.031), (I-746)+(1.074)+(2.032), (I-746)+(1.074)+(2.033), (I-746)+(1.074)+(2.034), (I-746)+(1.074)+(2.035), (I-746)+(1.074)+(2.036), (I-746)+(1.074)+(2.037), (I-746)+(1.074)+(2.038), (I-746)+(1.074)+(2.039), (I-746)+(1.074)+(2.040), (I-746)+(1.074)+(2.041), (I-746)+(1.074)+(2.042), (I-746)+(1.074)+(2.043), (I-746)+(1.074)+(2.044), (I-746)+(1.074)+(2.045), (I-746)+(1.074)+(2.046), (I-746)+(1.074)+(2.047), (I-746)+(1.074)+(2.048), (I-746)+(1.074)+(2.049), (I-746)+(1.074)+(2.050), (I-746)+(1.074)+(2.051), (I-746)+(1.074)+(2.052), (I-746)+(1.074)+(2.053), (I-746)+(1.074)+(2.054), (I-746)+(1.074)+(2.055), (I-746)+(1.074)+(2.056), (I-746)+(1.074)+(2.057), (I-746)+(1.074)+(2.058), (I-746)+(1.074)+(2.059), (I-746)+(1.074)+(3.001), (I-746)+(1.074)+(3.002), (I-746)+(1.074)+(3.003), (I-746)+(1.074)+(3.004), (I-746)+(1.074)+(3.005), (I-746)+(1.074)+(3.006), (I-746)+(1.074)+(3.007), (I-746)+(1.074)+(3.008), (I-746)+(1.074)+(3.009), (I-746)+(1.074)+(3.010), (I-746)+(1.074)+(3.011), (I-746)+(1.074)+(3.012), (I-746)+(1.074)+(3.013), (I-746)+(1.074)+(3.014), (I-746)+(1.074)+(3.015), (I-746)+(1.074)+(3.016), (I-746)+(1.074)+(3.017), (I-746)+(1.074)+(3.018), (I-746)+(1.074)+(3.019), (I-746)+(1.074)+(3.020), (I-746)+(1.074)+(3.021), (I-746)+(1.074)+(3.022), (I-746)+(1.074)+(3.023), (I-746)+(1.074)+(3.024), (I-746)+(1.074)+(3.025), (I-746)+(1.074)+(3.026), (I-746)+(1.074)+(3.027), (I-746)+(1.074)+(3.028), (I-746)+(1.074)+(3.029), (I-746)+(1.074)+(3.030), (I-746)+(1.074)+(3.031), (I-746)+(1.074)+(5.001), (I-746)+(1.074)+(5.002), (I-746)+(1.074)+(5.003), (I-746)+(1.074)+(5.004), (I-746)+(1.074)+(5.005), (I-746)+(1.074)+(5.006), (I-746)+(1.074)+(5.007), (I-746)+(1.074)+(5.008), (I-746)+(1.074)+(5.009), (I-746)+(1.074)+(5.010), (I-746)+(1.074)+(5.011), (I-746)+(1.074)+(5.012), (I-746)+(1.074)+(5.013), (I-746)+(1.074)+(5.014), (I-746)+(1.074)+(5.015), (I-746)+(1.074)+(5.016), (I-746)+(1.074)+(5.017), (I-746)+(1.074)+(5.018), (I-746)+(1.074)+(5.019), (I-746)+(1.074)+(5.020), (I-746)+(1.074)+(5.021), (I-746)+(1.074)+(5.022), (I-746)+(1.074)+(5.023), (I-746)+(1.074)+(6.001), (I-746)+(1.074)+(6.002), (I-746)+(1.074)+(6.003), (I-746)+(1.074)+(6.004), (I-746)+(1.074)+(7.001), (I-746)+(1.074)+(7.002), (I-746)+(1.074)+(7.003), (I-746)+(1.074)+(7.004), (I-746)+(1.074)+(7.005), (I-746)+(1.074)+(7.006), (I-746)+(1.074)+(9.001), (I-746)+(1.074)+(9.002), (I-746)+(1.074)+(9.003), (I-746)+(1.074)+(9.004), (I-746)+(1.074)+(9.005), (I-746)+(1.074)+(9.006), (I-746)+(1.074)+(9.007), (I-746)+(1.074)+(9.008), (I-746)+(1.074)+(9.009), (I-746)+(1.074)+(14.001), (I-746)+(1.074)+(14.002), (I-746)+(1.074)+(15.008), (I-746)+(1.074)+(15.011), (I-746)+(1.074)+(15.012), (I-746)+(1.074)+(15.016), (I-746)+(1.074)+(15.025), (I-746)+(1.074)+(15.027), (I-746)+(1.074)+(15.047), (I-746)+(1.074)+(15.063), (I-746)+(1.074)+(15.064), (I-746)+(1.074)+(16.001), (I-746)+(1.074)+(16.002), (I-746)+(1.074)+(16.003), (I-746)+(1.074)+(16.004), (I-746)+(1.074)+(16.005), (I-746)+(1.074)+(16.006), (I-746)+(1.074)+(16.007), (I-746)+(1.074)+(16.008), (I-746)+(1.074)+(17.001), (I-746)+(1.074)+(17.002), (I-746)+(1.074)+(17.003), (I-746)+(1.074)+(17.004), (I-746)+(1.074)+(17.005), (I-746)+(1.074)+(17.006), (I-746)+(1.074)+(17.007), (I-746)+(1.074)+(17.008), (I-746)+(1.074)+(17.009), (I-746)+(1.074)+(17.010), (I-746)+(1.074)+(17.011), (I-746)+(1.074)+(17.012), (I-746)+(1.074)+(18.001),

(I-746)+(1.075)+(1.076), (I-746)+(1.075)+(1.077), (I-746)+(1.075)+(1.078), (I-746)+(1.075)+(1.079), (I-746)+(1.075)+(1.080), (I-746)+(1.075)+(1.081), (I-746)+(1.075)+(1.082), (I-746)+(1.075)+(1.083), (I-746)+(1.075)+(1.084), (I-746)+(1.075)+(1.085), (I-746)+(1.075)+(1.086), (I-746)+(1.075)+(1.087), (I-746)+(1.075)+(1.088), (I-746)+(1.075)+(1.089), (I-746)+(1.075)+(1.090), (I-746)+(1.075)+(1.091), (I-746)+(1.075)+(1.092), (I-746)+(1.075)+(2.001), (I-746)+(1.075)+(2.002), (I-746)+(1.075)+(2.003), (I-746)+(1.075)+(2.004), (I-746)+(1.075)+(2.005), (I-746)+(1.075)+(2.006), (I-746)+(1.075)+(2.007), (I-746)+(1.075)+(2.008), (I-746)+(1.075)+(2.009), (I-746)+(1.075)+(2.010), (I-746)+(1.075)+(2.011), (I-746)+(1.075)+(2.012), (I-746)+(1.075)+(2.013), (I-746)+(1.075)+(2.014), (I-746)+(1.075)+(2.015), (I-746)+(1.075)+(2.016), (I-746)+(1.075)+(2.017), (I-746)+(1.075)+(2.018), (I-746)+(1.075)+(2.019), (I-746)+(1.075)+(2.020), (I-746)+(1.075)+(2.021), (I-746)+(1.075)+(2.022), (I-746)+(1.075)+(2.023), (I-746)+(1.075)+(2.024), (I-746)+(1.075)+(2.025), (I-746)+(1.075)+(2.026), (I-746)+(1.075)+(2.027), (I-746)+(1.075)+(2.028), (I-746)+(1.075)+(2.029), (I-746)+(1.075)+(2.030), (I-746)+(1.075)+(2.031), (I-746)+(1.075)+(2.032), (I-746)+(1.075)+(2.033), (I-746)+(1.075)+(2.034), (I-746)+(1.075)+(2.035), (I-746)+(1.075)+(2.036), (I-746)+(1.075)+(2.037), (I-746)+(1.075)+(2.038), (I-746)+(1.075)+(2.039), (I-746)+(1.075)+(2.040), (I-746)+(1.075)+(2.041), (I-746)+(1.075)+(2.042), (I-746)+(1.075)+(2.043), (I-746)+(1.075)+(2.044), (I-746)+(1.075)+(2.045), (I-746)+(1.075)+(2.046), (I-746)+(1.075)+(2.047), (I-746)+(1.075)+(2.048), (I-746)+(1.075)+(2.049), (I-746)+(1.075)+(2.050), (I-746)+(1.075)+(2.051), (I-746)+(1.075)+(2.052), (I-746)+(1.075)+(2.053), (I-746)+(1.075)+(2.054), (I-746)+(1.075)+(2.055), (I-746)+(1.075)+(2.056), (I-746)+(1.075)+(2.057), (I-746)+(1.075)+(2.058), (I-746)+(1.075)+(2.059), (I-746)+(1.075)+(3.001), (I-746)+(1.075)+(3.002), (I-746)+(1.075)+(3.003), (I-746)+(1.075)+(3.004), (I-746)+(1.075)+(3.005), (I-746)+(1.075)+(3.006), (I-746)+(1.075)+(3.007), (I-746)+(1.075)+(3.008), (I-746)+(1.075)+(3.009), (I-746)+(1.075)+(3.010), (I-746)+(1.075)+(3.011), (I-746)+(1.075)+(3.012), (I-746)+(1.075)+(3.013), (I-746)+(1.075)+(3.014), (I-746)+(1.075)+(3.015), (I-746)+(1.075)+(3.016), (I-746)+(1.075)+(3.017), (I-746)+(1.075)+(3.018), (I-746)+(1.075)+(3.019), (I-746)+(1.075)+(3.020), (I-746)+(1.075)+(3.021), (I-746)+(1.075)+(3.022), (I-746)+(1.075)+(3.023), (I-746)+(1.075)+(3.024), (I-746)+(1.075)+(3.025), (I-746)+(1.075)+(3.026), (I-746)+(1.075)+(3.027), (I-746)+(1.075)+(3.028), (I-746)+(1.075)+(3.029), (I-746)+(1.075)+(3.030), (I-746)+(1.075)+(3.031), (I-746)+(1.075)+(5.001), (I-746)+(1.075)+(5.002), (I-746)+(1.075)+(5.003), (I-746)+(1.075)+(5.004), (I-746)+(1.075)+(5.005), (I-746)+(1.075)+(5.006), (I-746)+(1.075)+(5.007), (I-746)+(1.075)+(5.008), (I-746)+(1.075)+(5.009), (I-746)+(1.075)+(5.010), (I-746)+(1.075)+(5.011), (I-746)+(1.075)+(5.012), (I-746)+(1.075)+(5.013), (I-746)+(1.075)+(5.014), (I-746)+(1.075)+(5.015), (I-746)+(1.075)+(5.016), (I-746)+(1.075)+(5.017), (I-746)+(1.075)+(5.018), (I-746)+(1.075)+(5.019), (I-746)+(1.075)+(5.020), (I-746)+(1.075)+(5.021), (I-746)+(1.075)+(5.022), (I-746)+(1.075)+(5.023), (I-746)+(1.075)+(6.001), (I-746)+(1.075)+(6.002), (I-746)+(1.075)+(6.003), (I-746)+(1.075)+(6.004), (I-746)+(1.075)+(7.001), (I-746)+(1.075)+(7.002), (I-746)+(1.075)+(7.003), (I-746)+(1.075)+(7.004), (I-746)+(1.075)+(7.005), (I-746)+(1.075)+(7.006), (I-746)+(1.075)+(9.001), (I-746)+(1.075)+(9.002), (I-746)+(1.075)+(9.003), (I-746)+(1.075)+(9.004), (I-746)+(1.075)+(9.005), (I-746)+(1.075)+(9.006), (I-746)+(1.075)+(9.007), (I-746)+(1.075)+(9.008), (I-746)+(1.075)+(9.009), (I-746)+(1.075)+(14.001), (I-746)+(1.075)+(14.002), (I-746)+(1.075)+(15.008), (I-746)+(1.075)+(15.011), (I-746)+(1.075)+(15.012), (I-746)+(1.075)+(15.016), (I-746)+(1.075)+(15.025), (I-746)+(1.075)+(15.027), (I-746)+(1.075)+(15.047), (I-746)+(1.075)+(15.063), (I-746)+(1.075)+(15.064), (I-746)+(1.075)+(16.001), (I-746)+(1.075)+(16.002), (I-746)+(1.075)+(16.003), (I-746)+(1.075)+(16.004), (I-746)+(1.075)+(16.005), (I-746)+(1.075)+(16.006), (I-746)+(1.075)+(16.007), (I-746)+(1.075)+(16.008), (I-746)+(1.075)+(17.001), (I-746)+(1.075)+(17.002), (I-746)+(1.075)+(17.003), (I-746)+(1.075)+(17.004), (I-746)+(1.075)+(17.005), (I-746)+(1.075)+(17.006), (I-746)+(1.075)+(17.007), (I-746)+(1.075)+(17.008), (I-746)+(1.075)+(17.009), (I-746)+(1.075)+(17.010), (I-746)+(1.075)+(17.011), (I-746)+(1.075)+(17.012), (I-746)+(1.075)+(18.001),

(I-746)+(1.076)+(1.077), (I-746)+(1.076)+(1.078), (I-746)+(1.076)+(1.079), (I-746)+(1.076)+(1.080), (I-746)+(1.076)+(1.081), (I-746)+(1.076)+(1.082), (I-746)+(1.076)+(1.083), (I-746)+(1.076)+(1.084), (I-746)+(1.076)+(1.085), (I-746)+(1.076)+(1.086), (I-746)+(1.076)+(1.087), (I-746)+(1.076)+(1.088), (I-746)+(1.076)+(1.089), (I-746)+(1.076)+(1.090), (I-746)+(1.076)+(1.091), (I-746)+(1.076)+(1.092), (I-746)+(1.076)+(2.001), (I-746)+(1.076)+(2.002), (I-746)+(1.076)+(2.003), (I-746)+(1.076)+(2.004), (I-746)+(1.076)+(2.005), (I-746)+(1.076)+(2.006), (I-746)+(1.076)+(2.007), (I-746)+(1.076)+(2.008), (I-746)+(1.076)+(2.009), (I-746)+(1.076)+(2.010), (I-746)+(1.076)+(2.011), (I-746)+(1.076)+(2.012), (I-746)+(1.076)+(2.013), (I-746)+(1.076)+(2.014), (I-746)+(1.076)+(2.015), (I-746)+(1.076)+(2.016), (I-746)+(1.076)+(2.017), (I-746)+(1.076)+(2.018), (I-746)+(1.076)+(2.019), (I-746)+(1.076)+(2.020), (I-746)+(1.076)+(2.021), (I-746)+(1.076)+(2.022), (I-746)+(1.076)+(2.023), (I-746)+(1.076)+(2.024), (I-746)+(1.076)+(2.025), (I-746)+(1.076)+(2.026), (I-746)+(1.076)+(2.027), (I-746)+(1.076)+(2.028), (I-746)+(1.076)+(2.029), (I-746)+(1.076)+(2.030), (I-746)+(1.076)+(2.031), (I-746)+(1.076)+(2.032), (I-746)+(1.076)+(2.033), (I-746)+(1.076)+(2.034), (I-746)+(1.076)+(2.035), (I-746)+(1.076)+(2.036), (I-746)+(1.076)+(2.037), (I-746)+(1.076)+(2.038), (I-746)+(1.076)+(2.039), (I-746)+(1.076)+(2.040), (I-746)+(1.076)+(2.041), (I-746)+(1.076)+(2.042), (I-746)+(1.076)+(2.043), (I-746)+(1.076)+(2.044), (I-746)+(1.076)+(2.045), (I-746)+(1.076)+(2.046), (I-746)+(1.076)+(2.047), (I-746)+(1.076)+(2.048), (I-746)+(1.076)+(2.049), (I-746)+(1.076)+(2.050), (I-746)+(1.076)+(2.051), (I-746)+(1.076)+(2.052), (I-746)+(1.076)+(2.053), (I-746)+(1.076)+(2.054), (I-746)+(1.076)+(2.055), (I-746)+(1.076)+(2.056), (I-746)+(1.076)+(2.057), (I-746)+(1.076)+(2.058), (I-746)+(1.076)+(2.059), (I-746)+(1.076)+(3.001), (I-746)+(1.076)+(3.002), (I-746)+(1.076)+(3.003), (I-746)+(1.076)+(3.004), (I-746)+(1.076)+(3.005), (I-746)+(1.076)+(3.006), (I-746)+(1.076)+(3.007), (I-746)+(1.076)+(3.008), (I-746)+(1.076)+(3.009), (I-746)+(1.076)+(3.010), (I-746)+(1.076)+(3.011), (I-746)+(1.076)+(3.012), (I-746)+(1.076)+(3.013), (I-746)+(1.076)+(3.014), (I-746)+(1.076)+(3.015), (I-746)+(1.076)+(3.016), (I-746)+(1.076)+(3.017), (I-746)+(1.076)+(3.018), (I-746)+(1.076)+(3.019), (I-746)+(1.076)+(3.020), (I-746)+(1.076)+(3.021), (I-746)+(1.076)+(3.022), (I-746)+(1.076)+(3.023), (I-746)+(1.076)+(3.024), (I-746)+(1.076)+(3.025), (I-746)+(1.076)+(3.026), (I-746)+(1.076)+(3.027), (I-746)+(1.076)+(3.028), (I-746)+(1.076)+(3.029), (I-746)+(1.076)+(3.030), (I-746)+(1.076)+(3.031), (I-746)+(1.076)+(5.001), (I-746)+(1.076)+(5.002), (I-746)+(1.076)+(5.003), (I-746)+(1.076)+(5.004), (I-746)+(1.076)+(5.005), (I-746)+(1.076)+(5.006), (I-746)+(1.076)+(5.007), (I-746)+(1.076)+(5.008), (I-746)+(1.076)+(5.009), (I-746)+(1.076)+(5.010), (I-746)+(1.076)+(5.011), (I-746)+(1.076)+(5.012), (I-746)+(1.076)+(5.013), (I-746)+(1.076)+(5.014), (I-746)+(1.076)+(5.015), (I-746)+(1.076)+(5.016), (I-746)+(1.076)+(5.017), (I-746)+(1.076)+(5.018), (I-746)+(1.076)+(5.019), (I-746)+(1.076)+(5.020), (I-746)+(1.076)+(5.021), (I-746)+(1.076)+(5.022), (I-746)+(1.076)+(5.023), (I-746)+(1.076)+(6.001), (I-746)+(1.076)+(6.002), (I-746)+(1.076)+(6.003), (I-746)+(1.076)+(6.004), (I-746)+(1.076)+(7.001), (I-746)+(1.076)+(7.002), (I-746)+(1.076)+(7.003), (I-746)+(1.076)+(7.004), (I-746)+(1.076)+(7.005), (I-746)+(1.076)+(7.006), (I-746)+(1.076)+(9.001), (I-746)+(1.076)+(9.002), (I-746)+(1.076)+(9.003), (I-746)+(1.076)+(9.004), (I-746)+(1.076)+(9.005), (I-746)+(1.076)+(9.006), (I-746)+(1.076)+(9.007), (I-746)+(1.076)+(9.008), (I-746)+(1.076)+(9.009), (I-746)+(1.076)+(14.001), (I-746)+(1.076)+(14.002), (I-746)+(1.076)+(15.008), (I-746)+(1.076)+(15.011), (I-746)+(1.076)+(15.012), (I-746)+(1.076)+(15.016), (I-746)+(1.076)+(15.025), (I-746)+(1.076)+(15.027), (I-746)+(1.076)+(15.047), (I-746)+(1.076)+(15.063), (I-746)+(1.076)+(15.064), (I-746)+(1.076)+(16.001), (I-746)+(1.076)+(16.002), (I-746)+(1.076)+(16.003), (I-746)+(1.076)+(16.004), (I-746)+(1.076)+(16.005), (I-746)+(1.076)+(16.006), (I-746)+(1.076)+(16.007), (I-746)+(1.076)+(16.008), (I-746)+(1.076)+(17.001), (I-746)+(1.076)+(17.002), (I-746)+(1.076)+(17.003), (I-746)+(1.076)+(17.004), (I-746)+(1.076)+(17.005), (I-746)+(1.076)+(17.006), (I-746)+(1.076)+(17.007), (I-746)+(1.076)+(17.008), (I-746)+(1.076)+(17.009), (I-746)+(1.076)+(17.010), (I-746)+(1.076)+(17.011), (I-746)+(1.076)+(17.012), (I-746)+(1.076)+(18.001),

(I-746)+(1.077)+(1.078), (I-746)+(1.077)+(1.079), (I-746)+(1.077)+(1.080), (I-746)+(1.077)+(1.081), (I-746)+(1.077)+(1.082), (I-746)+(1.077)+(1.083), (I-746)+(1.077)+(1.084), (I-746)+(1.077)+(1.085), (I-746)+(1.077)+(1.086), (I-746)+(1.077)+(1.087), (I-746)+(1.077)+(1.088), (I-746)+(1.077)+(1.089), (I-746)+(1.077)+(1.090), (I-746)+(1.077)+(1.091), (I-746)+(1.077)+(1.092), (I-746)+(1.077)+(2.001), (I-746)+(1.077)+(2.002), (I-746)+(1.077)+(2.003), (I-746)+(1.077)+(2.004), (I-746)+(1.077)+(2.005), (I-746)+(1.077)+(2.006), (I-746)+(1.077)+(2.007), (I-746)+(1.077)+(2.008), (I-746)+(1.077)+(2.009), (I-746)+(1.077)+(2.010), (I-746)+(1.077)+(2.011), (I-746)+(1.077)+(2.012), (I-746)+(1.077)+(2.013), (I-746)+(1.077)+(2.014), (I-746)+(1.077)+(2.015), (I-746)+(1.077)+(2.016), (I-746)+(1.077)+(2.017), (I-746)+(1.077)+(2.018), (I-746)+(1.077)+(2.019), (I-746)+(1.077)+(2.020), (I-746)+(1.077)+(2.021), (I-746)+(1.077)+(2.022), (I-746)+(1.077)+(2.023), (I-746)+(1.077)+(2.024), (I-746)+(1.077)+(2.025), (I-746)+(1.077)+(2.026), (I-746)+(1.077)+(2.027), (I-746)+(1.077)+(2.028), (I-746)+(1.077)+(2.029), (I-746)+(1.077)+(2.030), (I-746)+(1.077)+(2.031), (I-746)+(1.077)+(2.032), (I-746)+(1.077)+(2.033), (I-746)+(1.077)+(2.034), (I-746)+(1.077)+(2.035), (I-746)+(1.077)+(2.036), (I-746)+(1.077)+(2.037), (I-746)+(1.077)+(2.038), (I-746)+(1.077)+(2.039), (I-746)+(1.077)+(2.040), (I-746)+(1.077)+(2.041), (I-746)+(1.077)+(2.042), (I-746)+(1.077)+(2.043), (I-746)+(1.077)+(2.044), (I-746)+(1.077)+(2.045), (I-746)+(1.077)+(2.046), (I-746)+(1.077)+(2.047), (I-746)+(1.077)+(2.048), (I-746)+(1.077)+(2.049), (I-746)+(1.077)+(2.050), (I-746)+(1.077)+(2.051), (I-746)+(1.077)+(2.052), (I-746)+(1.077)+(2.053), (I-746)+(1.077)+(2.054), (I-746)+(1.077)+(2.055), (I-746)+(1.077)+(2.056), (I-746)+(1.077)+(2.057), (I-746)+(1.077)+(2.058), (I-746)+(1.077)+(2.059), (I-746)+(1.077)+(3.001), (I-746)+(1.077)+(3.002), (I-746)+(1.077)+(3.003), (I-746)+(1.077)+(3.004), (I-746)+(1.077)+(3.005), (I-746)+(1.077)+(3.006), (I-746)+(1.077)+(3.007), (I-746)+(1.077)+(3.008), (I-746)+(1.077)+(3.009), (I-746)+(1.077)+(3.010), (I-746)+(1.077)+(3.011), (I-746)+(1.077)+(3.012), (I-746)+(1.077)+(3.013), (I-746)+(1.077)+(3.014), (I-746)+(1.077)+(3.015), (I-746)+(1.077)+(3.016), (I-746)+(1.077)+(3.017), (I-746)+(1.077)+(3.018), (I-746)+(1.077)+(3.019), (I-746)+(1.077)+(3.020), (I-746)+(1.077)+(3.021), (I-746)+(1.077)+(3.022), (I-746)+(1.077)+(3.023), (I-746)+(1.077)+(3.024), (I-746)+(1.077)+(3.025), (I-746)+(1.077)+(3.026), (I-746)+(1.077)+(3.027), (I-746)+(1.077)+(3.028), (I-746)+(1.077)+(3.029), (I-746)+(1.077)+(3.030), (I-746)+(1.077)+(3.031), (I-746)+(1.077)+(5.001), (I-746)+(1.077)+(5.002), (I-746)+(1.077)+(5.003), (I-746)+(1.077)+(5.004), (I-746)+(1.077)+(5.005), (I-746)+(1.077)+(5.006), (I-746)+(1.077)+(5.007), (I-746)+(1.077)+(5.008), (I-746)+(1.077)+(5.009), (I-746)+(1.077)+(5.010), (I-746)+(1.077)+(5.011), (I-746)+(1.077)+(5.012), (I-746)+(1.077)+(5.013), (I-746)+(1.077)+(5.014), (I-746)+(1.077)+(5.015), (I-746)+(1.077)+(5.016), (I-746)+(1.077)+(5.017), (I-746)+(1.077)+(5.018), (I-746)+(1.077)+(5.019), (I-746)+(1.077)+(5.020), (I-746)+(1.077)+(5.021), (I-746)+(1.077)+(5.022), (I-746)+(1.077)+(5.023), (I-746)+(1.077)+(6.001), (I-746)+(1.077)+(6.002), (I-746)+(1.077)+(6.003), (I-746)+(1.077)+(6.004), (I-746)+(1.077)+(7.001), (I-746)+(1.077)+(7.002), (I-746)+(1.077)+(7.003), (I-746)+(1.077)+(7.004), (I-746)+(1.077)+(7.005), (I-746)+(1.077)+(7.006), (I-746)+(1.077)+(9.001), (I-746)+(1.077)+(9.002), (I-746)+(1.077)+(9.003), (I-746)+(1.077)+(9.004), (I-746)+(1.077)+(9.005), (I-746)+(1.077)+(9.006), (I-746)+(1.077)+(9.007), (I-746)+(1.077)+(9.008), (I-746)+(1.077)+(9.009), (I-746)+(1.077)+(14.001), (I-746)+(1.077)+(14.002), (I-746)+(1.077)+(15.008), (I-746)+(1.077)+(15.011), (I-746)+(1.077)+(15.012), (I-746)+(1.077)+(15.016), (I-746)+(1.077)+(15.025), (I-746)+(1.077)+(15.027), (I-746)+(1.077)+(15.047), (I-746)+(1.077)+(15.063), (I-746)+(1.077)+(15.064), (I-746)+(1.077)+(16.001), (I-746)+(1.077)+(16.002), (I-746)+(1.077)+(16.003), (I-746)+(1.077)+(16.004), (I-746)+(1.077)+(16.005), (I-746)+(1.077)+(16.006), (I-746)+(1.077)+(16.007), (I-746)+(1.077)+(16.008), (I-746)+(1.077)+(17.001), (I-746)+(1.077)+(17.002), (I-746)+(1.077)+(17.003), (I-746)+(1.077)+(17.004), (I-746)+(1.077)+(17.005), (I-746)+(1.077)+(17.006), (I-746)+(1.077)+(17.007), (I-746)+(1.077)+(17.008), (I-746)+(1.077)+(17.009), (I-746)+(1.077)+(17.010), (I-746)+(1.077)+(17.011), (I-746)+(1.077)+(17.012), (I-746)+(1.077)+(18.001),

(I-746)+(1.078)+(1.079), (I-746)+(1.078)+(1.080), (I-746)+(1.078)+(1.081), (I-746)+(1.078)+(1.082), (I-746)+(1.078)+(1.083), (I-746)+(1.078)+(1.084), (I-746)+(1.078)+(1.085), (I-746)+(1.078)+(1.086), (I-746)+(1.078)+(1.087), (I-746)+(1.078)+(1.088), (I-746)+(1.078)+(1.089), (I-746)+(1.078)+(1.090), (I-746)+(1.078)+(1.091), (I-746)+(1.078)+(1.092), (I-746)+(1.078)+(2.001), (I-746)+(1.078)+(2.002), (I-746)+(1.078)+(2.003), (I-746)+(1.078)+(2.004), (I-746)+(1.078)+(2.005), (I-746)+(1.078)+(2.006), (I-746)+(1.078)+(2.007), (I-746)+(1.078)+(2.008), (I-746)+(1.078)+(2.009), (I-746)+(1.078)+(2.010), (I-746)+(1.078)+(2.011), (I-746)+(1.078)+(2.012), (I-746)+(1.078)+(2.013), (I-746)+(1.078)+(2.014), (I-746)+(1.078)+(2.015), (I-746)+(1.078)+(2.016), (I-746)+(1.078)+(2.017), (I-746)+(1.078)+(2.018), (I-746)+(1.078)+(2.019), (I-746)+(1.078)+(2.020), (I-746)+(1.078)+(2.021), (I-746)+(1.078)+(2.022), (I-746)+(1.078)+(2.023), (I-746)+(1.078)+(2.024), (I-746)+(1.078)+(2.025), (I-746)+(1.078)+(2.026), (I-746)+(1.078)+(2.027), (I-746)+(1.078)+(2.028), (I-746)+(1.078)+(2.029), (I-746)+(1.078)+(2.030), (I-746)+(1.078)+(2.031), (I-746)+(1.078)+(2.032), (I-746)+(1.078)+(2.033), (I-746)+(1.078)+(2.034), (I-746)+(1.078)+(2.035), (I-746)+(1.078)+(2.036), (I-746)+(1.078)+(2.037), (I-746)+(1.078)+(2.038), (I-746)+(1.078)+(2.039), (I-746)+(1.078)+(2.040), (I-746)+(1.078)+(2.041), (I-746)+(1.078)+(2.042), (I-746)+(1.078)+(2.043), (I-746)+(1.078)+(2.044), (I-746)+(1.078)+(2.045), (I-746)+(1.078)+(2.046), (I-746)+(1.078)+(2.047), (I-746)+(1.078)+(2.048), (I-746)+(1.078)+(2.049), (I-746)+(1.078)+(2.050), (I-746)+(1.078)+(2.051), (I-746)+(1.078)+(2.052), (I-746)+(1.078)+(2.053), (I-746)+(1.078)+(2.054), (I-746)+(1.078)+(2.055), (I-746)+(1.078)+(2.056), (I-746)+(1.078)+(2.057), (I-746)+(1.078)+(2.058), (I-746)+(1.078)+(2.059), (I-746)+(1.078)+(3.001), (I-746)+(1.078)+(3.002), (I-746)+(1.078)+(3.003), (I-746)+(1.078)+(3.004), (I-746)+(1.078)+(3.005), (I-746)+(1.078)+(3.006), (I-746)+(1.078)+(3.007), (I-746)+(1.078)+(3.008), (I-746)+(1.078)+(3.009), (I-746)+(1.078)+(3.010), (I-746)+(1.078)+(3.011), (I-746)+(1.078)+(3.012), (I-746)+(1.078)+(3.013), (I-746)+(1.078)+(3.014), (I-746)+(1.078)+(3.015), (I-746)+(1.078)+(3.016), (I-746)+(1.078)+(3.017), (I-746)+(1.078)+(3.018), (I-746)+(1.078)+(3.019), (I-746)+(1.078)+(3.020), (I-746)+(1.078)+(3.021), (I-746)+(1.078)+(3.022), (I-746)+(1.078)+(3.023), (I-746)+(1.078)+(3.024), (I-746)+(1.078)+(3.025), (I-746)+(1.078)+(3.026), (I-746)+(1.078)+(3.027), (I-746)+(1.078)+(3.028), (I-746)+(1.078)+(3.029), (I-746)+(1.078)+(3.030), (I-746)+(1.078)+(3.031), (I-746)+(1.078)+(5.001), (I-746)+(1.078)+(5.002), (I-746)+(1.078)+(5.003), (I-746)+(1.078)+(5.004), (I-746)+(1.078)+(5.005), (I-746)+(1.078)+(5.006), (I-746)+(1.078)+(5.007), (I-746)+(1.078)+(5.008), (I-746)+(1.078)+(5.009), (I-746)+(1.078)+(5.010), (I-746)+(1.078)+(5.011), (I-746)+(1.078)+(5.012), (I-746)+(1.078)+(5.013), (I-746)+(1.078)+(5.014), (I-746)+(1.078)+(5.015), (I-746)+(1.078)+(5.016), (I-746)+(1.078)+(5.017), (I-746)+(1.078)+(5.018), (I-746)+(1.078)+(5.019), (I-746)+(1.078)+(5.020), (I-746)+(1.078)+(5.021), (I-746)+(1.078)+(5.022), (I-746)+(1.078)+(5.023), (I-746)+(1.078)+(6.001), (I-746)+(1.078)+(6.002), (I-746)+(1.078)+(6.003), (I-746)+(1.078)+(6.004), (I-746)+(1.078)+(7.001), (I-746)+(1.078)+(7.002), (I-746)+(1.078)+(7.003), (I-746)+(1.078)+(7.004), (I-746)+(1.078)+(7.005), (I-746)+(1.078)+(7.006), (I-746)+(1.078)+(9.001), (I-746)+(1.078)+(9.002), (I-746)+(1.078)+(9.003), (I-746)+(1.078)+(9.004), (I-746)+(1.078)+(9.005), (I-746)+(1.078)+(9.006), (I-746)+(1.078)+(9.007), (I-746)+(1.078)+(9.008), (I-746)+(1.078)+(9.009), (I-746)+(1.078)+(14.001), (I-746)+(1.078)+(14.002), (I-746)+(1.078)+(15.008), (I-746)+(1.078)+(15.011), (I-746)+(1.078)+(15.012), (I-746)+(1.078)+(15.016), (I-746)+(1.078)+(15.025), (I-746)+(1.078)+(15.027), (I-746)+(1.078)+(15.047), (I-746)+(1.078)+(15.063), (I-746)+(1.078)+(15.064), (I-746)+(1.078)+(16.001), (I-746)+(1.078)+(16.002), (I-746)+(1.078)+(16.003), (I-746)+(1.078)+(16.004), (I-746)+(1.078)+(16.005), (I-746)+(1.078)+(16.006), (I-746)+(1.078)+(16.007), (I-746)+(1.078)+(16.008), (I-746)+(1.078)+(17.001), (I-746)+(1.078)+(17.002), (I-746)+(1.078)+(17.003), (I-746)+(1.078)+(17.004), (I-746)+(1.078)+(17.005), (I-746)+(1.078)+(17.006), (I-746)+(1.078)+(17.007), (I-746)+(1.078)+(17.008), (I-746)+(1.078)+(17.009), (I-746)+(1.078)+(17.010), (I-746)+(1.078)+(17.011), (I-746)+(1.078)+(17.012), (I-746)+(1.078)+(18.001),

(I-746)+(1.079)+(1.080), (I-746)+(1.079)+(1.081), (I-746)+(1.079)+(1.082), (I-746)+(1.079)+(1.083), (I-746)+(1.079)+(1.084), (I-746)+(1.079)+(1.085), (I-746)+(1.079)+(1.086), (I-746)+(1.079)+(1.087), (I-746)+(1.079)+(1.088), (I-746)+(1.079)+(1.089), (I-746)+(1.079)+(1.090), (I-746)+(1.079)+(1.091), (I-746)+(1.079)+(1.092), (I-746)+(1.079)+(2.001), (I-746)+(1.079)+(2.002), (I-746)+(1.079)+(2.003), (I-746)+(1.079)+(2.004), (I-746)+(1.079)+(2.005), (I-746)+(1.079)+(2.006), (I-746)+(1.079)+(2.007), (I-746)+(1.079)+(2.008), (I-746)+(1.079)+(2.009), (I-746)+(1.079)+(2.010), (I-746)+(1.079)+(2.011), (I-746)+(1.079)+(2.012), (I-746)+(1.079)+(2.013), (I-746)+(1.079)+(2.014), (I-746)+(1.079)+(2.015), (I-746)+(1.079)+(2.016), (I-746)+(1.079)+(2.017), (I-746)+(1.079)+(2.018), (I-746)+(1.079)+(2.019), (I-746)+(1.079)+(2.020), (I-746)+(1.079)+(2.021), (I-746)+(1.079)+(2.022), (I-746)+(1.079)+(2.023), (I-746)+(1.079)+(2.024), (I-746)+(1.079)+(2.025), (I-746)+(1.079)+(2.026), (I-746)+(1.079)+(2.027), (I-746)+(1.079)+(2.028), (I-746)+(1.079)+(2.029), (I-746)+(1.079)+(2.030), (I-746)+(1.079)+(2.031), (I-746)+(1.079)+(2.032), (I-746)+(1.079)+(2.033), (I-746)+(1.079)+(2.034), (I-746)+(1.079)+(2.035), (I-746)+(1.079)+(2.036), (I-746)+(1.079)+(2.037), (I-746)+(1.079)+(2.038), (I-746)+(1.079)+(2.039), (I-746)+(1.079)+(2.040), (I-746)+(1.079)+(2.041), (I-746)+(1.079)+(2.042), (I-746)+(1.079)+(2.043), (I-746)+(1.079)+(2.044), (I-746)+(1.079)+(2.045), (I-746)+(1.079)+(2.046), (I-746)+(1.079)+(2.047), (I-746)+(1.079)+(2.048), (I-746)+(1.079)+(2.049), (I-746)+(1.079)+(2.050), (I-746)+(1.079)+(2.051), (I-746)+(1.079)+(2.052), (I-746)+(1.079)+(2.053), (I-746)+(1.079)+(2.054), (I-746)+(1.079)+(2.055), (I-746)+(1.079)+(2.056), (I-746)+(1.079)+(2.057), (I-746)+(1.079)+(2.058), (I-746)+(1.079)+(2.059), (I-746)+(1.079)+(3.001), (I-746)+(1.079)+(3.002), (I-746)+(1.079)+(3.003), (I-746)+(1.079)+(3.004), (I-746)+(1.079)+(3.005), (I-746)+(1.079)+(3.006), (I-746)+(1.079)+(3.007), (I-746)+(1.079)+(3.008), (I-746)+(1.079)+(3.009), (I-746)+(1.079)+(3.010), (I-746)+(1.079)+(3.011), (I-746)+(1.079)+(3.012), (I-746)+(1.079)+(3.013), (I-746)+(1.079)+(3.014), (I-746)+(1.079)+(3.015), (I-746)+(1.079)+(3.016), (I-746)+(1.079)+(3.017), (I-746)+(1.079)+(3.018), (I-746)+(1.079)+(3.019), (I-746)+(1.079)+(3.020), (I-746)+(1.079)+(3.021), (I-746)+(1.079)+(3.022), (I-746)+(1.079)+(3.023), (I-746)+(1.079)+(3.024), (I-746)+(1.079)+(3.025), (I-746)+(1.079)+(3.026), (I-746)+(1.079)+(3.027), (I-746)+(1.079)+(3.028), (I-746)+(1.079)+(3.029), (I-746)+(1.079)+(3.030), (I-746)+(1.079)+(3.031), (I-746)+(1.079)+(5.001), (I-746)+(1.079)+(5.002), (I-746)+(1.079)+(5.003), (I-746)+(1.079)+(5.004), (I-746)+(1.079)+(5.005), (I-746)+(1.079)+(5.006), (I-746)+(1.079)+(5.007), (I-746)+(1.079)+(5.008), (I-746)+(1.079)+(5.009), (I-746)+(1.079)+(5.010), (I-746)+(1.079)+(5.011), (I-746)+(1.079)+(5.012), (I-746)+(1.079)+(5.013), (I-746)+(1.079)+(5.014), (I-746)+(1.079)+(5.015), (I-746)+(1.079)+(5.016), (I-746)+(1.079)+(5.017), (I-746)+(1.079)+(5.018), (I-746)+(1.079)+(5.019), (I-746)+(1.079)+(5.020), (I-746)+(1.079)+(5.021), (I-746)+(1.079)+(5.022), (I-746)+(1.079)+(5.023), (I-746)+(1.079)+(6.001), (I-746)+(1.079)+(6.002), (I-746)+(1.079)+(6.003), (I-746)+(1.079)+(6.004), (I-746)+(1.079)+(7.001), (I-746)+(1.079)+(7.002), (I-746)+(1.079)+(7.003), (I-746)+(1.079)+(7.004), (I-746)+(1.079)+(7.005), (I-746)+(1.079)+(7.006), (I-746)+(1.079)+(9.001), (I-746)+(1.079)+(9.002), (I-746)+(1.079)+(9.003), (I-746)+(1.079)+(9.004), (I-746)+(1.079)+(9.005), (I-746)+(1.079)+(9.006), (I-746)+(1.079)+(9.007), (I-746)+(1.079)+(9.008), (I-746)+(1.079)+(9.009), (I-746)+(1.079)+(14.001), (I-746)+(1.079)+(14.002), (I-746)+(1.079)+(15.008), (I-746)+(1.079)+(15.011), (I-746)+(1.079)+(15.012), (I-746)+(1.079)+(15.016), (I-746)+(1.079)+(15.025), (I-746)+(1.079)+(15.027), (I-746)+(1.079)+(15.047), (I-746)+(1.079)+(15.063), (I-746)+(1.079)+(15.064), (I-746)+(1.079)+(16.001), (I-746)+(1.079)+(16.002), (I-746)+(1.079)+(16.003), (I-746)+(1.079)+(16.004), (I-746)+(1.079)+(16.005), (I-746)+(1.079)+(16.006), (I-746)+(1.079)+(16.007), (I-746)+(1.079)+(16.008), (I-746)+(1.079)+(17.001), (I-746)+(1.079)+(17.002), (I-746)+(1.079)+(17.003), (I-746)+(1.079)+(17.004), (I-746)+(1.079)+(17.005), (I-746)+(1.079)+(17.006), (I-746)+(1.079)+(17.007), (I-746)+(1.079)+(17.008), (I-746)+(1.079)+(17.009), (I-746)+(1.079)+(17.010), (I-746)+(1.079)+(17.011), (I-746)+(1.079)+(17.012), (I-746)+(1.079)+(18.001),

(I-746)+(1.080)+(1.081), (I-746)+(1.080)+(1.082), (I-746)+(1.080)+(1.083), (I-746)+(1.080)+(1.084), (I-746)+(1.080)+(1.085), (I-746)+(1.080)+(1.086), (I-746)+(1.080)+(1.087), (I-746)+(1.080)+(1.088), (I-746)+(1.080)+(1.089), (I-746)+(1.080)+(1.090), (I-746)+(1.080)+(1.091), (I-746)+(1.080)+(1.092), (I-746)+(1.080)+(2.001), (I-746)+(1.080)+(2.002), (I-746)+(1.080)+(2.003), (I-746)+(1.080)+(2.004), (I-746)+(1.080)+(2.005), (I-746)+(1.080)+(2.006), (I-746)+(1.080)+(2.007), (I-746)+(1.080)+(2.008), (I-746)+(1.080)+(2.009), (I-746)+(1.080)+(2.010), (I-746)+(1.080)+(2.011), (I-746)+(1.080)+(2.012), (I-746)+(1.080)+(2.013), (I-746)+(1.080)+(2.014), (I-746)+(1.080)+(2.015), (I-746)+(1.080)+(2.016), (I-746)+(1.080)+(2.017), (I-746)+(1.080)+(2.018), (I-746)+(1.080)+(2.019), (I-746)+(1.080)+(2.020), (I-746)+(1.080)+(2.021), (I-746)+(1.080)+(2.022), (I-746)+(1.080)+(2.023), (I-746)+(1.080)+(2.024), (I-746)+(1.080)+(2.025), (I-746)+(1.080)+(2.026), (I-746)+(1.080)+(2.027), (I-746)+(1.080)+(2.028), (I-746)+(1.080)+(2.029), (I-746)+(1.080)+(2.030), (I-746)+(1.080)+(2.031), (I-746)+(1.080)+(2.032), (I-746)+(1.080)+(2.033), (I-746)+(1.080)+(2.034), (I-746)+(1.080)+(2.035), (I-746)+(1.080)+(2.036), (I-746)+(1.080)+(2.037), (I-746)+(1.080)+(2.038), (I-746)+(1.080)+(2.039), (I-746)+(1.080)+(2.040), (I-746)+(1.080)+(2.041), (I-746)+(1.080)+(2.042), (I-746)+(1.080)+(2.043), (I-746)+(1.080)+(2.044), (I-746)+(1.080)+(2.045), (I-746)+(1.080)+(2.046), (I-746)+(1.080)+(2.047), (I-746)+(1.080)+(2.048), (I-746)+(1.080)+(2.049), (I-746)+(1.080)+(2.050), (I-746)+(1.080)+(2.051), (I-746)+(1.080)+(2.052), (I-746)+(1.080)+(2.053), (I-746)+(1.080)+(2.054), (I-746)+(1.080)+(2.055), (I-746)+(1.080)+(2.056), (I-746)+(1.080)+(2.057), (I-746)+(1.080)+(2.058), (I-746)+(1.080)+(2.059), (I-746)+(1.080)+(3.001), (I-746)+(1.080)+(3.002), (I-746)+(1.080)+(3.003), (I-746)+(1.080)+(3.004), (I-746)+(1.080)+(3.005), (I-746)+(1.080)+(3.006), (I-746)+(1.080)+(3.007), (I-746)+(1.080)+(3.008), (I-746)+(1.080)+(3.009), (I-746)+(1.080)+(3.010), (I-746)+(1.080)+(3.011), (I-746)+(1.080)+(3.012), (I-746)+(1.080)+(3.013), (I-746)+(1.080)+(3.014), (I-746)+(1.080)+(3.015), (I-746)+(1.080)+(3.016), (I-746)+(1.080)+(3.017), (I-746)+(1.080)+(3.018), (I-746)+(1.080)+(3.019), (I-746)+(1.080)+(3.020), (I-746)+(1.080)+(3.021), (I-746)+(1.080)+(3.022), (I-746)+(1.080)+(3.023), (I-746)+(1.080)+(3.024), (I-746)+(1.080)+(3.025), (I-746)+(1.080)+(3.026), (I-746)+(1.080)+(3.027), (I-746)+(1.080)+(3.028), (I-746)+(1.080)+(3.029), (I-746)+(1.080)+(3.030), (I-746)+(1.080)+(3.031), (I-746)+(1.080)+(5.001), (I-746)+(1.080)+(5.002), (I-746)+(1.080)+(5.003), (I-746)+(1.080)+(5.004), (I-746)+(1.080)+(5.005), (I-746)+(1.080)+(5.006), (I-746)+(1.080)+(5.007), (I-746)+(1.080)+(5.008), (I-746)+(1.080)+(5.009), (I-746)+(1.080)+(5.010), (I-746)+(1.080)+(5.011), (I-746)+(1.080)+(5.012), (I-746)+(1.080)+(5.013), (I-746)+(1.080)+(5.014), (I-746)+(1.080)+(5.015), (I-746)+(1.080)+(5.016), (I-746)+(1.080)+(5.017), (I-746)+(1.080)+(5.018), (I-746)+(1.080)+(5.019), (I-746)+(1.080)+(5.020), (I-746)+(1.080)+(5.021), (I-746)+(1.080)+(5.022), (I-746)+(1.080)+(5.023), (I-746)+(1.080)+(6.001), (I-746)+(1.080)+(6.002), (I-746)+(1.080)+(6.003), (I-746)+(1.080)+(6.004), (I-746)+(1.080)+(7.001), (I-746)+(1.080)+(7.002), (I-746)+(1.080)+(7.003), (I-746)+(1.080)+(7.004), (I-746)+(1.080)+(7.005), (I-746)+(1.080)+(7.006), (I-746)+(1.080)+(9.001), (I-746)+(1.080)+(9.002), (I-746)+(1.080)+(9.003), (I-746)+(1.080)+(9.004), (I-746)+(1.080)+(9.005), (I-746)+(1.080)+(9.006), (I-746)+(1.080)+(9.007), (I-746)+(1.080)+(9.008), (I-746)+(1.080)+(9.009), (I-746)+(1.080)+(14.001), (I-746)+(1.080)+(14.002), (I-746)+(1.080)+(15.008), (I-746)+(1.080)+(15.011), (I-746)+(1.080)+(15.012), (I-746)+(1.080)+(15.016), (I-746)+(1.080)+(15.025), (I-746)+(1.080)+(15.027), (I-746)+(1.080)+(15.047), (I-746)+(1.080)+(15.063), (I-746)+(1.080)+(15.064), (I-746)+(1.080)+(16.001), (I-746)+(1.080)+(16.002), (I-746)+(1.080)+(16.003), (I-746)+(1.080)+(16.004), (I-746)+(1.080)+(16.005), (I-746)+(1.080)+(16.006), (I-746)+(1.080)+(16.007), (I-746)+(1.080)+(16.008), (I-746)+(1.080)+(17.001), (I-746)+(1.080)+(17.002), (I-746)+(1.080)+(17.003), (I-746)+(1.080)+(17.004), (I-746)+(1.080)+(17.005), (I-746)+(1.080)+(17.006), (I-746)+(1.080)+(17.007), (I-746)+(1.080)+(17.008), (I-746)+(1.080)+(17.009), (I-746)+(1.080)+(17.010), (I-746)+(1.080)+(17.011), (I-746)+(1.080)+(17.012), (I-746)+(1.080)+(18.001),

(I-746)+(1.081)+(1.082), (I-746)+(1.081)+(1.083), (I-746)+(1.081)+(1.084), (I-746)+(1.081)+(1.085), (I-746)+(1.081)+(1.086), (I-746)+(1.081)+(1.087), (I-746)+(1.081)+(1.088), (I-746)+(1.081)+(1.089), (I-746)+(1.081)+(1.090), (I-746)+(1.081)+(1.091), (I-746)+(1.081)+(1.092), (I-746)+(1.081)+(2.001), (I-746)+(1.081)+(2.002), (I-746)+(1.081)+(2.003), (I-746)+(1.081)+(2.004), (I-746)+(1.081)+(2.005), (I-746)+(1.081)+(2.006), (I-746)+(1.081)+(2.007), (I-746)+(1.081)+(2.008), (I-746)+(1.081)+(2.009), (I-746)+(1.081)+(2.010), (I-746)+(1.081)+(2.011), (I-746)+(1.081)+(2.012), (I-746)+(1.081)+(2.013), (I-746)+(1.081)+(2.014), (I-746)+(1.081)+(2.015), (I-746)+(1.081)+(2.016), (I-746)+(1.081)+(2.017), (I-746)+(1.081)+(2.018), (I-746)+(1.081)+(2.019), (I-746)+(1.081)+(2.020), (I-746)+(1.081)+(2.021), (I-746)+(1.081)+(2.022), (I-746)+(1.081)+(2.023), (I-746)+(1.081)+(2.024), (I-746)+(1.081)+(2.025), (I-746)+(1.081)+(2.026), (I-746)+(1.081)+(2.027), (I-746)+(1.081)+(2.028), (I-746)+(1.081)+(2.029), (I-746)+(1.081)+(2.030), (I-746)+(1.081)+(2.031), (I-746)+(1.081)+(2.032), (I-746)+(1.081)+(2.033), (I-746)+(1.081)+(2.034), (I-746)+(1.081)+(2.035), (I-746)+(1.081)+(2.036), (I-746)+(1.081)+(2.037), (I-746)+(1.081)+(2.038), (I-746)+(1.081)+(2.039), (I-746)+(1.081)+(2.040), (I-746)+(1.081)+(2.041), (I-746)+(1.081)+(2.042), (I-746)+(1.081)+(2.043), (I-746)+(1.081)+(2.044), (I-746)+(1.081)+(2.045), (I-746)+(1.081)+(2.046), (I-746)+(1.081)+(2.047), (I-746)+(1.081)+(2.048), (I-746)+(1.081)+(2.049), (I-746)+(1.081)+(2.050), (I-746)+(1.081)+(2.051), (I-746)+(1.081)+(2.052), (I-746)+(1.081)+(2.053), (I-746)+(1.081)+(2.054), (I-746)+(1.081)+(2.055), (I-746)+(1.081)+(2.056), (I-746)+(1.081)+(2.057), (I-746)+(1.081)+(2.058), (I-746)+(1.081)+(2.059), (I-746)+(1.081)+(3.001), (I-746)+(1.081)+(3.002), (I-746)+(1.081)+(3.003), (I-746)+(1.081)+(3.004), (I-746)+(1.081)+(3.005), (I-746)+(1.081)+(3.006), (I-746)+(1.081)+(3.007), (I-746)+(1.081)+(3.008), (I-746)+(1.081)+(3.009), (I-746)+(1.081)+(3.010), (I-746)+(1.081)+(3.011), (I-746)+(1.081)+(3.012), (I-746)+(1.081)+(3.013), (I-746)+(1.081)+(3.014), (I-746)+(1.081)+(3.015), (I-746)+(1.081)+(3.016), (I-746)+(1.081)+(3.017), (I-746)+(1.081)+(3.018), (I-746)+(1.081)+(3.019), (I-746)+(1.081)+(3.020), (I-746)+(1.081)+(3.021), (I-746)+(1.081)+(3.022), (I-746)+(1.081)+(3.023), (I-746)+(1.081)+(3.024), (I-746)+(1.081)+(3.025), (I-746)+(1.081)+(3.026), (I-746)+(1.081)+(3.027), (I-746)+(1.081)+(3.028), (I-746)+(1.081)+(3.029), (I-746)+(1.081)+(3.030), (I-746)+(1.081)+(3.031), (I-746)+(1.081)+(5.001), (I-746)+(1.081)+(5.002), (I-746)+(1.081)+(5.003), (I-746)+(1.081)+(5.004), (I-746)+(1.081)+(5.005), (I-746)+(1.081)+(5.006), (I-746)+(1.081)+(5.007), (I-746)+(1.081)+(5.008), (I-746)+(1.081)+(5.009), (I-746)+(1.081)+(5.010), (I-746)+(1.081)+(5.011), (I-746)+(1.081)+(5.012), (I-746)+(1.081)+(5.013), (I-746)+(1.081)+(5.014), (I-746)+(1.081)+(5.015), (I-746)+(1.081)+(5.016), (I-746)+(1.081)+(5.017), (I-746)+(1.081)+(5.018), (I-746)+(1.081)+(5.019), (I-746)+(1.081)+(5.020), (I-746)+(1.081)+(5.021), (I-746)+(1.081)+(5.022), (I-746)+(1.081)+(5.023), (I-746)+(1.081)+(6.001), (I-746)+(1.081)+(6.002), (I-746)+(1.081)+(6.003), (I-746)+(1.081)+(6.004), (I-746)+(1.081)+(7.001), (I-746)+(1.081)+(7.002), (I-746)+(1.081)+(7.003), (I-746)+(1.081)+(7.004), (I-746)+(1.081)+(7.005), (I-746)+(1.081)+(7.006), (I-746)+(1.081)+(9.001), (I-746)+(1.081)+(9.002), (I-746)+(1.081)+(9.003), (I-746)+(1.081)+(9.004), (I-746)+(1.081)+(9.005), (I-746)+(1.081)+(9.006), (I-746)+(1.081)+(9.007), (I-746)+(1.081)+(9.008), (I-746)+(1.081)+(9.009), (I-746)+(1.081)+(14.001), (I-746)+(1.081)+(14.002), (I-746)+(1.081)+(15.008), (I-746)+(1.081)+(15.011), (I-746)+(1.081)+(15.012), (I-746)+(1.081)+(15.016), (I-746)+(1.081)+(15.025), (I-746)+(1.081)+(15.027), (I-746)+(1.081)+(15.047), (I-746)+(1.081)+(15.063), (I-746)+(1.081)+(15.064), (I-746)+(1.081)+(16.001), (I-746)+(1.081)+(16.002), (I-746)+(1.081)+(16.003), (I-746)+(1.081)+(16.004), (I-746)+(1.081)+(16.005), (I-746)+(1.081)+(16.006), (I-746)+(1.081)+(16.007), (I-746)+(1.081)+(16.008), (I-746)+(1.081)+(17.001), (I-746)+(1.081)+(17.002), (I-746)+(1.081)+(17.003), (I-746)+(1.081)+(17.004), (I-746)+(1.081)+(17.005), (I-746)+(1.081)+(17.006), (I-746)+(1.081)+(17.007), (I-746)+(1.081)+(17.008), (I-746)+(1.081)+(17.009), (I-746)+(1.081)+(17.010), (I-746)+(1.081)+(17.011), (I-746)+(1.081)+(17.012), (I-746)+(1.081)+(18.001),

(I-746)+(1.082)+(1.083), (I-746)+(1.082)+(1.084), (I-746)+(1.082)+(1.085), (I-746)+(1.082)+(1.086), (I-746)+(1.082)+(1.087), (I-746)+(1.082)+(1.088), (I-746)+(1.082)+(1.089), (I-746)+(1.082)+(1.090), (I-746)+(1.082)+(1.091), (I-746)+(1.082)+(1.092), (I-746)+(1.082)+(2.001), (I-746)+(1.082)+(2.002), (I-746)+(1.082)+(2.003), (I-746)+(1.082)+(2.004), (I-746)+(1.082)+(2.005), (I-746)+(1.082)+(2.006), (I-746)+(1.082)+(2.007), (I-746)+(1.082)+(2.008), (I-746)+(1.082)+(2.009), (I-746)+(1.082)+(2.010), (I-746)+(1.082)+(2.011), (I-746)+(1.082)+(2.012), (I-746)+(1.082)+(2.013), (I-746)+(1.082)+(2.014), (I-746)+(1.082)+(2.015), (I-746)+(1.082)+(2.016), (I-746)+(1.082)+(2.017), (I-746)+(1.082)+(2.018), (I-746)+(1.082)+(2.019), (I-746)+(1.082)+(2.020), (I-746)+(1.082)+(2.021), (I-746)+(1.082)+(2.022), (I-746)+(1.082)+(2.023), (I-746)+(1.082)+(2.024), (I-746)+(1.082)+(2.025), (I-746)+(1.082)+(2.026), (I-746)+(1.082)+(2.027), (I-746)+(1.082)+(2.028), (I-746)+(1.082)+(2.029), (I-746)+(1.082)+(2.030), (I-746)+(1.082)+(2.031), (I-746)+(1.082)+(2.032), (I-746)+(1.082)+(2.033), (I-746)+(1.082)+(2.034), (I-746)+(1.082)+(2.035), (I-746)+(1.082)+(2.036), (I-746)+(1.082)+(2.037), (I-746)+(1.082)+(2.038), (I-746)+(1.082)+(2.039), (I-746)+(1.082)+(2.040), (I-746)+(1.082)+(2.041), (I-746)+(1.082)+(2.042), (I-746)+(1.082)+(2.043), (I-746)+(1.082)+(2.044), (I-746)+(1.082)+(2.045), (I-746)+(1.082)+(2.046), (I-746)+(1.082)+(2.047), (I-746)+(1.082)+(2.048), (I-746)+(1.082)+(2.049), (I-746)+(1.082)+(2.050), (I-746)+(1.082)+(2.051), (I-746)+(1.082)+(2.052), (I-746)+(1.082)+(2.053), (I-746)+(1.082)+(2.054), (I-746)+(1.082)+(2.055), (I-746)+(1.082)+(2.056), (I-746)+(1.082)+(2.057), (I-746)+(1.082)+(2.058), (I-746)+(1.082)+(2.059), (I-746)+(1.082)+(3.001), (I-746)+(1.082)+(3.002), (I-746)+(1.082)+(3.003), (I-746)+(1.082)+(3.004), (I-746)+(1.082)+(3.005), (I-746)+(1.082)+(3.006), (I-746)+(1.082)+(3.007), (I-746)+(1.082)+(3.008), (I-746)+(1.082)+(3.009), (I-746)+(1.082)+(3.010), (I-746)+(1.082)+(3.011), (I-746)+(1.082)+(3.012), (I-746)+(1.082)+(3.013), (I-746)+(1.082)+(3.014), (I-746)+(1.082)+(3.015), (I-746)+(1.082)+(3.016), (I-746)+(1.082)+(3.017), (I-746)+(1.082)+(3.018), (I-746)+(1.082)+(3.019), (I-746)+(1.082)+(3.020), (I-746)+(1.082)+(3.021), (I-746)+(1.082)+(3.022), (I-746)+(1.082)+(3.023), (I-746)+(1.082)+(3.024), (I-746)+(1.082)+(3.025), (I-746)+(1.082)+(3.026), (I-746)+(1.082)+(3.027), (I-746)+(1.082)+(3.028), (I-746)+(1.082)+(3.029), (I-746)+(1.082)+(3.030), (I-746)+(1.082)+(3.031), (I-746)+(1.082)+(5.001), (I-746)+(1.082)+(5.002), (I-746)+(1.082)+(5.003), (I-746)+(1.082)+(5.004), (I-746)+(1.082)+(5.005), (I-746)+(1.082)+(5.006), (I-746)+(1.082)+(5.007), (I-746)+(1.082)+(5.008), (I-746)+(1.082)+(5.009), (I-746)+(1.082)+(5.010), (I-746)+(1.082)+(5.011), (I-746)+(1.082)+(5.012), (I-746)+(1.082)+(5.013), (I-746)+(1.082)+(5.014), (I-746)+(1.082)+(5.015), (I-746)+(1.082)+(5.016), (I-746)+(1.082)+(5.017), (I-746)+(1.082)+(5.018), (I-746)+(1.082)+(5.019), (I-746)+(1.082)+(5.020), (I-746)+(1.082)+(5.021), (I-746)+(1.082)+(5.022), (I-746)+(1.082)+(5.023), (I-746)+(1.082)+(6.001), (I-746)+(1.082)+(6.002), (I-746)+(1.082)+(6.003), (I-746)+(1.082)+(6.004), (I-746)+(1.082)+(7.001), (I-746)+(1.082)+(7.002), (I-746)+(1.082)+(7.003), (I-746)+(1.082)+(7.004), (I-746)+(1.082)+(7.005), (I-746)+(1.082)+(7.006), (I-746)+(1.082)+(9.001), (I-746)+(1.082)+(9.002), (I-746)+(1.082)+(9.003), (I-746)+(1.082)+(9.004), (I-746)+(1.082)+(9.005), (I-746)+(1.082)+(9.006), (I-746)+(1.082)+(9.007), (I-746)+(1.082)+(9.008), (I-746)+(1.082)+(9.009), (I-746)+(1.082)+(14.001), (I-746)+(1.082)+(14.002), (I-746)+(1.082)+(15.008), (I-746)+(1.082)+(15.011), (I-746)+(1.082)+(15.012), (I-746)+(1.082)+(15.016), (I-746)+(1.082)+(15.025), (I-746)+(1.082)+(15.027), (I-746)+(1.082)+(15.047), (I-746)+(1.082)+(15.063), (I-746)+(1.082)+(15.064), (I-746)+(1.082)+(16.001), (I-746)+(1.082)+(16.002), (I-746)+(1.082)+(16.003), (I-746)+(1.082)+(16.004), (I-746)+(1.082)+(16.005), (I-746)+(1.082)+(16.006), (I-746)+(1.082)+(16.007), (I-746)+(1.082)+(16.008), (I-746)+(1.082)+(17.001), (I-746)+(1.082)+(17.002), (I-746)+(1.082)+(17.003), (I-746)+(1.082)+(17.004), (I-746)+(1.082)+(17.005), (I-746)+(1.082)+(17.006), (I-746)+(1.082)+(17.007), (I-746)+(1.082)+(17.008), (I-746)+(1.082)+(17.009), (I-746)+(1.082)+(17.010), (I-746)+(1.082)+(17.011), (I-746)+(1.082)+(17.012), (I-746)+(1.082)+(18.001),

(I-746)+(1.083)+(1.084), (I-746)+(1.083)+(1.085), (I-746)+(1.083)+(1.086), (I-746)+(1.083)+(1.087), (I-746)+(1.083)+(1.088), (I-746)+(1.083)+(1.089), (I-746)+(1.083)+(1.090), (I-746)+(1.083)+(1.091), (I-746)+(1.083)+(1.092), (I-746)+(1.083)+(2.001), (I-746)+(1.083)+(2.002), (I-746)+(1.083)+(2.003), (I-746)+(1.083)+(2.004), (I-746)+(1.083)+(2.005), (I-746)+(1.083)+(2.006), (I-746)+(1.083)+(2.007), (I-746)+(1.083)+(2.008), (I-746)+(1.083)+(2.009), (I-746)+(1.083)+(2.010), (I-746)+(1.083)+(2.011), (I-746)+(1.083)+(2.012), (I-746)+(1.083)+(2.013), (I-746)+(1.083)+(2.014), (I-746)+(1.083)+(2.015), (I-746)+(1.083)+(2.016), (I-746)+(1.083)+(2.017), (I-746)+(1.083)+(2.018), (I-746)+(1.083)+(2.019), (I-746)+(1.083)+(2.020), (I-746)+(1.083)+(2.021), (I-746)+(1.083)+(2.022), (I-746)+(1.083)+(2.023), (I-746)+(1.083)+(2.024), (I-746)+(1.083)+(2.025), (I-746)+(1.083)+(2.026), (I-746)+(1.083)+(2.027), (I-746)+(1.083)+(2.028), (I-746)+(1.083)+(2.029), (I-746)+(1.083)+(2.030), (I-746)+(1.083)+(2.031), (I-746)+(1.083)+(2.032), (I-746)+(1.083)+(2.033), (I-746)+(1.083)+(2.034), (I-746)+(1.083)+(2.035), (I-746)+(1.083)+(2.036), (I-746)+(1.083)+(2.037), (I-746)+(1.083)+(2.038), (I-746)+(1.083)+(2.039), (I-746)+(1.083)+(2.040), (I-746)+(1.083)+(2.041), (I-746)+(1.083)+(2.042), (I-746)+(1.083)+(2.043), (I-746)+(1.083)+(2.044), (I-746)+(1.083)+(2.045), (I-746)+(1.083)+(2.046), (I-746)+(1.083)+(2.047), (I-746)+(1.083)+(2.048), (I-746)+(1.083)+(2.049), (I-746)+(1.083)+(2.050), (I-746)+(1.083)+(2.051), (I-746)+(1.083)+(2.052), (I-746)+(1.083)+(2.053), (I-746)+(1.083)+(2.054), (I-746)+(1.083)+(2.055), (I-746)+(1.083)+(2.056), (I-746)+(1.083)+(2.057), (I-746)+(1.083)+(2.058), (I-746)+(1.083)+(2.059), (I-746)+(1.083)+(3.001), (I-746)+(1.083)+(3.002), (I-746)+(1.083)+(3.003), (I-746)+(1.083)+(3.004), (I-746)+(1.083)+(3.005), (I-746)+(1.083)+(3.006), (I-746)+(1.083)+(3.007), (I-746)+(1.083)+(3.008), (I-746)+(1.083)+(3.009), (I-746)+(1.083)+(3.010), (I-746)+(1.083)+(3.011), (I-746)+(1.083)+(3.012), (I-746)+(1.083)+(3.013), (I-746)+(1.083)+(3.014), (I-746)+(1.083)+(3.015), (I-746)+(1.083)+(3.016), (I-746)+(1.083)+(3.017), (I-746)+(1.083)+(3.018), (I-746)+(1.083)+(3.019), (I-746)+(1.083)+(3.020), (I-746)+(1.083)+(3.021), (I-746)+(1.083)+(3.022), (I-746)+(1.083)+(3.023), (I-746)+(1.083)+(3.024), (I-746)+(1.083)+(3.025), (I-746)+(1.083)+(3.026), (I-746)+(1.083)+(3.027), (I-746)+(1.083)+(3.028), (I-746)+(1.083)+(3.029), (I-746)+(1.083)+(3.030), (I-746)+(1.083)+(3.031), (I-746)+(1.083)+(5.001), (I-746)+(1.083)+(5.002), (I-746)+(1.083)+(5.003), (I-746)+(1.083)+(5.004), (I-746)+(1.083)+(5.005), (I-746)+(1.083)+(5.006), (I-746)+(1.083)+(5.007), (I-746)+(1.083)+(5.008), (I-746)+(1.083)+(5.009), (I-746)+(1.083)+(5.010), (I-746)+(1.083)+(5.011), (I-746)+(1.083)+(5.012), (I-746)+(1.083)+(5.013), (I-746)+(1.083)+(5.014), (I-746)+(1.083)+(5.015), (I-746)+(1.083)+(5.016), (I-746)+(1.083)+(5.017), (I-746)+(1.083)+(5.018), (I-746)+(1.083)+(5.019), (I-746)+(1.083)+(5.020), (I-746)+(1.083)+(5.021), (I-746)+(1.083)+(5.022), (I-746)+(1.083)+(5.023), (I-746)+(1.083)+(6.001), (I-746)+(1.083)+(6.002), (I-746)+(1.083)+(6.003), (I-746)+(1.083)+(6.004), (I-746)+(1.083)+(7.001), (I-746)+(1.083)+(7.002), (I-746)+(1.083)+(7.003), (I-746)+(1.083)+(7.004), (I-746)+(1.083)+(7.005), (I-746)+(1.083)+(7.006), (I-746)+(1.083)+(9.001), (I-746)+(1.083)+(9.002), (I-746)+(1.083)+(9.003), (I-746)+(1.083)+(9.004), (I-746)+(1.083)+(9.005), (I-746)+(1.083)+(9.006), (I-746)+(1.083)+(9.007), (I-746)+(1.083)+(9.008), (I-746)+(1.083)+(9.009), (I-746)+(1.083)+(14.001), (I-746)+(1.083)+(14.002), (I-746)+(1.083)+(15.008), (I-746)+(1.083)+(15.011), (I-746)+(1.083)+(15.012), (I-746)+(1.083)+(15.016), (I-746)+(1.083)+(15.025), (I-746)+(1.083)+(15.027), (I-746)+(1.083)+(15.047), (I-746)+(1.083)+(15.063), (I-746)+(1.083)+(15.064), (I-746)+(1.083)+(16.001), (I-746)+(1.083)+(16.002), (I-746)+(1.083)+(16.003), (I-746)+(1.083)+(16.004), (I-746)+(1.083)+(16.005), (I-746)+(1.083)+(16.006), (I-746)+(1.083)+(16.007), (I-746)+(1.083)+(16.008), (I-746)+(1.083)+(17.001), (I-746)+(1.083)+(17.002), (I-746)+(1.083)+(17.003), (I-746)+(1.083)+(17.004), (I-746)+(1.083)+(17.005), (I-746)+(1.083)+(17.006), (I-746)+(1.083)+(17.007), (I-746)+(1.083)+(17.008), (I-746)+(1.083)+(17.009), (I-746)+(1.083)+(17.010), (I-746)+(1.083)+(17.011), (I-746)+(1.083)+(17.012), (I-746)+(1.083)+(18.001),

(I-746)+(1.084)+(1.085), (I-746)+(1.084)+(1.086), (I-746)+(1.084)+(1.087), (I-746)+(1.084)+(1.088), (I-746)+(1.084)+(1.089), (I-746)+(1.084)+(1.090), (I-746)+(1.084)+(1.091), (I-746)+(1.084)+(1.092), (I-746)+(1.084)+(2.001), (I-746)+(1.084)+(2.002), (I-746)+(1.084)+(2.003), (I-746)+(1.084)+(2.004), (I-746)+(1.084)+(2.005), (I-746)+(1.084)+(2.006), (I-746)+(1.084)+(2.007), (I-746)+(1.084)+(2.008), (I-746)+(1.084)+(2.009), (I-746)+(1.084)+(2.010), (I-746)+(1.084)+(2.011), (I-746)+(1.084)+(2.012), (I-746)+(1.084)+(2.013), (I-746)+(1.084)+(2.014), (I-746)+(1.084)+(2.015), (I-746)+(1.084)+(2.016), (I-746)+(1.084)+(2.017), (I-746)+(1.084)+(2.018), (I-746)+(1.084)+(2.019), (I-746)+(1.084)+(2.020), (I-746)+(1.084)+(2.021), (I-746)+(1.084)+(2.022), (I-746)+(1.084)+(2.023), (I-746)+(1.084)+(2.024), (I-746)+(1.084)+(2.025), (I-746)+(1.084)+(2.026), (I-746)+(1.084)+(2.027), (I-746)+(1.084)+(2.028), (I-746)+(1.084)+(2.029), (I-746)+(1.084)+(2.030), (I-746)+(1.084)+(2.031), (I-746)+(1.084)+(2.032), (I-746)+(1.084)+(2.033), (I-746)+(1.084)+(2.034), (I-746)+(1.084)+(2.035), (I-746)+(1.084)+(2.036), (I-746)+(1.084)+(2.037), (I-746)+(1.084)+(2.038), (I-746)+(1.084)+(2.039), (I-746)+(1.084)+(2.040), (I-746)+(1.084)+(2.041), (I-746)+(1.084)+(2.042), (I-746)+(1.084)+(2.043), (I-746)+(1.084)+(2.044), (I-746)+(1.084)+(2.045), (I-746)+(1.084)+(2.046), (I-746)+(1.084)+(2.047), (I-746)+(1.084)+(2.048), (I-746)+(1.084)+(2.049), (I-746)+(1.084)+(2.050), (I-746)+(1.084)+(2.051), (I-746)+(1.084)+(2.052), (I-746)+(1.084)+(2.053), (I-746)+(1.084)+(2.054), (I-746)+(1.084)+(2.055), (I-746)+(1.084)+(2.056), (I-746)+(1.084)+(2.057), (I-746)+(1.084)+(2.058), (I-746)+(1.084)+(2.059), (I-746)+(1.084)+(3.001), (I-746)+(1.084)+(3.002), (I-746)+(1.084)+(3.003), (I-746)+(1.084)+(3.004), (I-746)+(1.084)+(3.005), (I-746)+(1.084)+(3.006), (I-746)+(1.084)+(3.007), (I-746)+(1.084)+(3.008), (I-746)+(1.084)+(3.009), (I-746)+(1.084)+(3.010), (I-746)+(1.084)+(3.011), (I-746)+(1.084)+(3.012), (I-746)+(1.084)+(3.013), (I-746)+(1.084)+(3.014), (I-746)+(1.084)+(3.015), (I-746)+(1.084)+(3.016), (I-746)+(1.084)+(3.017), (I-746)+(1.084)+(3.018), (I-746)+(1.084)+(3.019), (I-746)+(1.084)+(3.020), (I-746)+(1.084)+(3.021), (I-746)+(1.084)+(3.022), (I-746)+(1.084)+(3.023), (I-746)+(1.084)+(3.024), (I-746)+(1.084)+(3.025), (I-746)+(1.084)+(3.026), (I-746)+(1.084)+(3.027), (I-746)+(1.084)+(3.028), (I-746)+(1.084)+(3.029), (I-746)+(1.084)+(3.030), (I-746)+(1.084)+(3.031), (I-746)+(1.084)+(5.001), (I-746)+(1.084)+(5.002), (I-746)+(1.084)+(5.003), (I-746)+(1.084)+(5.004), (I-746)+(1.084)+(5.005), (I-746)+(1.084)+(5.006), (I-746)+(1.084)+(5.007), (I-746)+(1.084)+(5.008), (I-746)+(1.084)+(5.009), (I-746)+(1.084)+(5.010), (I-746)+(1.084)+(5.011), (I-746)+(1.084)+(5.012), (I-746)+(1.084)+(5.013), (I-746)+(1.084)+(5.014), (I-746)+(1.084)+(5.015), (I-746)+(1.084)+(5.016), (I-746)+(1.084)+(5.017), (I-746)+(1.084)+(5.018), (I-746)+(1.084)+(5.019), (I-746)+(1.084)+(5.020), (I-746)+(1.084)+(5.021), (I-746)+(1.084)+(5.022), (I-746)+(1.084)+(5.023), (I-746)+(1.084)+(6.001), (I-746)+(1.084)+(6.002), (I-746)+(1.084)+(6.003), (I-746)+(1.084)+(6.004), (I-746)+(1.084)+(7.001), (I-746)+(1.084)+(7.002), (I-746)+(1.084)+(7.003), (I-746)+(1.084)+(7.004), (I-746)+(1.084)+(7.005), (I-746)+(1.084)+(7.006), (I-746)+(1.084)+(9.001), (I-746)+(1.084)+(9.002), (I-746)+(1.084)+(9.003), (I-746)+(1.084)+(9.004), (I-746)+(1.084)+(9.005), (I-746)+(1.084)+(9.006), (I-746)+(1.084)+(9.007), (I-746)+(1.084)+(9.008), (I-746)+(1.084)+(9.009), (I-746)+(1.084)+(14.001), (I-746)+(1.084)+(14.002), (I-746)+(1.084)+(15.008), (I-746)+(1.084)+(15.011), (I-746)+(1.084)+(15.012), (I-746)+(1.084)+(15.016), (I-746)+(1.084)+(15.025), (I-746)+(1.084)+(15.027), (I-746)+(1.084)+(15.047), (I-746)+(1.084)+(15.063), (I-746)+(1.084)+(15.064), (I-746)+(1.084)+(16.001), (I-746)+(1.084)+(16.002), (I-746)+(1.084)+(16.003), (I-746)+(1.084)+(16.004), (I-746)+(1.084)+(16.005), (I-746)+(1.084)+(16.006), (I-746)+(1.084)+(16.007), (I-746)+(1.084)+(16.008), (I-746)+(1.084)+(17.001), (I-746)+(1.084)+(17.002), (I-746)+(1.084)+(17.003), (I-746)+(1.084)+(17.004), (I-746)+(1.084)+(17.005), (I-746)+(1.084)+(17.006), (I-746)+(1.084)+(17.007), (I-746)+(1.084)+(17.008), (I-746)+(1.084)+(17.009), (I-746)+(1.084)+(17.010), (I-746)+(1.084)+(17.011), (I-746)+(1.084)+(17.012), (I-746)+(1.084)+(18.001),

(I-746)+(1.085)+(1.086), (I-746)+(1.085)+(1.087), (I-746)+(1.085)+(1.088), (I-746)+(1.085)+(1.089), (I-746)+(1.085)+(1.090), (I-746)+(1.085)+(1.091), (I-746)+(1.085)+(1.092), (I-746)+(1.085)+(2.001), (I-746)+(1.085)+(2.002), (I-746)+(1.085)+(2.003), (I-746)+(1.085)+(2.004), (I-746)+(1.085)+(2.005), (I-746)+(1.085)+(2.006), (I-746)+(1.085)+(2.007), (I-746)+(1.085)+(2.008), (I-746)+(1.085)+(2.009), (I-746)+(1.085)+(2.010), (I-746)+(1.085)+(2.011), (I-746)+(1.085)+(2.012), (I-746)+(1.085)+(2.013), (I-746)+(1.085)+(2.014), (I-746)+(1.085)+(2.015), (I-746)+(1.085)+(2.016), (I-746)+(1.085)+(2.017), (I-746)+(1.085)+(2.018), (I-746)+(1.085)+(2.019), (I-746)+(1.085)+(2.020), (I-746)+(1.085)+(2.021), (I-746)+(1.085)+(2.022), (I-746)+(1.085)+(2.023), (I-746)+(1.085)+(2.024), (I-746)+(1.085)+(2.025), (I-746)+(1.085)+(2.026), (I-746)+(1.085)+(2.027), (I-746)+(1.085)+(2.028), (I-746)+(1.085)+(2.029), (I-746)+(1.085)+(2.030), (I-746)+(1.085)+(2.031), (I-746)+(1.085)+(2.032), (I-746)+(1.085)+(2.033), (I-746)+(1.085)+(2.034), (I-746)+(1.085)+(2.035), (I-746)+(1.085)+(2.036), (I-746)+(1.085)+(2.037), (I-746)+(1.085)+(2.038), (I-746)+(1.085)+(2.039), (I-746)+(1.085)+(2.040), (I-746)+(1.085)+(2.041), (I-746)+(1.085)+(2.042), (I-746)+(1.085)+(2.043), (I-746)+(1.085)+(2.044), (I-746)+(1.085)+(2.045), (I-746)+(1.085)+(2.046), (I-746)+(1.085)+(2.047), (I-746)+(1.085)+(2.048), (I-746)+(1.085)+(2.049), (I-746)+(1.085)+(2.050), (I-746)+(1.085)+(2.051), (I-746)+(1.085)+(2.052), (I-746)+(1.085)+(2.053), (I-746)+(1.085)+(2.054), (I-746)+(1.085)+(2.055), (I-746)+(1.085)+(2.056), (I-746)+(1.085)+(2.057), (I-746)+(1.085)+(2.058), (I-746)+(1.085)+(2.059), (I-746)+(1.085)+(3.001), (I-746)+(1.085)+(3.002), (I-746)+(1.085)+(3.003), (I-746)+(1.085)+(3.004), (I-746)+(1.085)+(3.005), (I-746)+(1.085)+(3.006), (I-746)+(1.085)+(3.007), (I-746)+(1.085)+(3.008), (I-746)+(1.085)+(3.009), (I-746)+(1.085)+(3.010), (I-746)+(1.085)+(3.011), (I-746)+(1.085)+(3.012), (I-746)+(1.085)+(3.013), (I-746)+(1.085)+(3.014), (I-746)+(1.085)+(3.015), (I-746)+(1.085)+(3.016), (I-746)+(1.085)+(3.017), (I-746)+(1.085)+(3.018), (I-746)+(1.085)+(3.019), (I-746)+(1.085)+(3.020), (I-746)+(1.085)+(3.021), (I-746)+(1.085)+(3.022), (I-746)+(1.085)+(3.023), (I-746)+(1.085)+(3.024), (I-746)+(1.085)+(3.025), (I-746)+(1.085)+(3.026), (I-746)+(1.085)+(3.027), (I-746)+(1.085)+(3.028), (I-746)+(1.085)+(3.029), (I-746)+(1.085)+(3.030), (I-746)+(1.085)+(3.031), (I-746)+(1.085)+(5.001), (I-746)+(1.085)+(5.002), (I-746)+(1.085)+(5.003), (I-746)+(1.085)+(5.004), (I-746)+(1.085)+(5.005), (I-746)+(1.085)+(5.006), (I-746)+(1.085)+(5.007), (I-746)+(1.085)+(5.008), (I-746)+(1.085)+(5.009), (I-746)+(1.085)+(5.010), (I-746)+(1.085)+(5.011), (I-746)+(1.085)+(5.012), (I-746)+(1.085)+(5.013), (I-746)+(1.085)+(5.014), (I-746)+(1.085)+(5.015), (I-746)+(1.085)+(5.016), (I-746)+(1.085)+(5.017), (I-746)+(1.085)+(5.018), (I-746)+(1.085)+(5.019), (I-746)+(1.085)+(5.020), (I-746)+(1.085)+(5.021), (I-746)+(1.085)+(5.022), (I-746)+(1.085)+(5.023), (I-746)+(1.085)+(6.001), (I-746)+(1.085)+(6.002), (I-746)+(1.085)+(6.003), (I-746)+(1.085)+(6.004), (I-746)+(1.085)+(7.001), (I-746)+(1.085)+(7.002), (I-746)+(1.085)+(7.003), (I-746)+(1.085)+(7.004), (I-746)+(1.085)+(7.005), (I-746)+(1.085)+(7.006), (I-746)+(1.085)+(9.001), (I-746)+(1.085)+(9.002), (I-746)+(1.085)+(9.003), (I-746)+(1.085)+(9.004), (I-746)+(1.085)+(9.005), (I-746)+(1.085)+(9.006), (I-746)+(1.085)+(9.007), (I-746)+(1.085)+(9.008), (I-746)+(1.085)+(9.009), (I-746)+(1.085)+(14.001), (I-746)+(1.085)+(14.002), (I-746)+(1.085)+(15.008), (I-746)+(1.085)+(15.011), (I-746)+(1.085)+(15.012), (I-746)+(1.085)+(15.016), (I-746)+(1.085)+(15.025), (I-746)+(1.085)+(15.027), (I-746)+(1.085)+(15.047), (I-746)+(1.085)+(15.063), (I-746)+(1.085)+(15.064), (I-746)+(1.085)+(16.001), (I-746)+(1.085)+(16.002), (I-746)+(1.085)+(16.003), (I-746)+(1.085)+(16.004), (I-746)+(1.085)+(16.005), (I-746)+(1.085)+(16.006), (I-746)+(1.085)+(16.007), (I-746)+(1.085)+(16.008), (I-746)+(1.085)+(17.001), (I-746)+(1.085)+(17.002), (I-746)+(1.085)+(17.003), (I-746)+(1.085)+(17.004), (I-746)+(1.085)+(17.005), (I-746)+(1.085)+(17.006), (I-746)+(1.085)+(17.007), (I-746)+(1.085)+(17.008), (I-746)+(1.085)+(17.009), (I-746)+(1.085)+(17.010), (I-746)+(1.085)+(17.011), (I-746)+(1.085)+(17.012), (I-746)+(1.085)+(18.001),

(I-746)+(1.086)+(1.087), (I-746)+(1.086)+(1.088), (I-746)+(1.086)+(1.089), (I-746)+(1.086)+(1.090), (I-746)+(1.086)+(1.091), (I-746)+(1.086)+(1.092), (I-746)+(1.086)+(2.001), (I-746)+(1.086)+(2.002), (I-746)+(1.086)+(2.003), (I-746)+(1.086)+(2.004), (I-746)+(1.086)+(2.005), (I-746)+(1.086)+(2.006), (I-746)+(1.086)+(2.007), (I-746)+(1.086)+(2.008), (I-746)+(1.086)+(2.009), (I-746)+(1.086)+(2.010), (I-746)+(1.086)+(2.011), (I-746)+(1.086)+(2.012), (I-746)+(1.086)+(2.013), (I-746)+(1.086)+(2.014), (I-746)+(1.086)+(2.015), (I-746)+(1.086)+(2.016), (I-746)+(1.086)+(2.017), (I-746)+(1.086)+(2.018), (I-746)+(1.086)+(2.019), (I-746)+(1.086)+(2.020), (I-746)+(1.086)+(2.021), (I-746)+(1.086)+(2.022), (I-746)+(1.086)+(2.023), (I-746)+(1.086)+(2.024), (I-746)+(1.086)+(2.025), (I-746)+(1.086)+(2.026), (I-746)+(1.086)+(2.027), (I-746)+(1.086)+(2.028), (I-746)+(1.086)+(2.029), (I-746)+(1.086)+(2.030), (I-746)+(1.086)+(2.031), (I-746)+(1.086)+(2.032), (I-746)+(1.086)+(2.033), (I-746)+(1.086)+(2.034), (I-746)+(1.086)+(2.035), (I-746)+(1.086)+(2.036), (I-746)+(1.086)+(2.037), (I-746)+(1.086)+(2.038), (I-746)+(1.086)+(2.039), (I-746)+(1.086)+(2.040), (I-746)+(1.086)+(2.041), (I-746)+(1.086)+(2.042), (I-746)+(1.086)+(2.043), (I-746)+(1.086)+(2.044), (I-746)+(1.086)+(2.045), (I-746)+(1.086)+(2.046), (I-746)+(1.086)+(2.047), (I-746)+(1.086)+(2.048), (I-746)+(1.086)+(2.049), (I-746)+(1.086)+(2.050), (I-746)+(1.086)+(2.051), (I-746)+(1.086)+(2.052), (I-746)+(1.086)+(2.053), (I-746)+(1.086)+(2.054), (I-746)+(1.086)+(2.055), (I-746)+(1.086)+(2.056), (I-746)+(1.086)+(2.057), (I-746)+(1.086)+(2.058), (I-746)+(1.086)+(2.059), (I-746)+(1.086)+(3.001), (I-746)+(1.086)+(3.002), (I-746)+(1.086)+(3.003), (I-746)+(1.086)+(3.004), (I-746)+(1.086)+(3.005), (I-746)+(1.086)+(3.006), (I-746)+(1.086)+(3.007), (I-746)+(1.086)+(3.008), (I-746)+(1.086)+(3.009), (I-746)+(1.086)+(3.010), (I-746)+(1.086)+(3.011), (I-746)+(1.086)+(3.012), (I-746)+(1.086)+(3.013), (I-746)+(1.086)+(3.014), (I-746)+(1.086)+(3.015), (I-746)+(1.086)+(3.016), (I-746)+(1.086)+(3.017), (I-746)+(1.086)+(3.018), (I-746)+(1.086)+(3.019), (I-746)+(1.086)+(3.020), (I-746)+(1.086)+(3.021), (I-746)+(1.086)+(3.022), (I-746)+(1.086)+(3.023), (I-746)+(1.086)+(3.024), (I-746)+(1.086)+(3.025), (I-746)+(1.086)+(3.026), (I-746)+(1.086)+(3.027), (I-746)+(1.086)+(3.028), (I-746)+(1.086)+(3.029), (I-746)+(1.086)+(3.030), (I-746)+(1.086)+(3.031), (I-746)+(1.086)+(5.001), (I-746)+(1.086)+(5.002), (I-746)+(1.086)+(5.003), (I-746)+(1.086)+(5.004), (I-746)+(1.086)+(5.005), (I-746)+(1.086)+(5.006), (I-746)+(1.086)+(5.007), (I-746)+(1.086)+(5.008), (I-746)+(1.086)+(5.009), (I-746)+(1.086)+(5.010), (I-746)+(1.086)+(5.011), (I-746)+(1.086)+(5.012), (I-746)+(1.086)+(5.013), (I-746)+(1.086)+(5.014), (I-746)+(1.086)+(5.015), (I-746)+(1.086)+(5.016), (I-746)+(1.086)+(5.017), (I-746)+(1.086)+(5.018), (I-746)+(1.086)+(5.019), (I-746)+(1.086)+(5.020), (I-746)+(1.086)+(5.021), (I-746)+(1.086)+(5.022), (I-746)+(1.086)+(5.023), (I-746)+(1.086)+(6.001), (I-746)+(1.086)+(6.002), (I-746)+(1.086)+(6.003), (I-746)+(1.086)+(6.004), (I-746)+(1.086)+(7.001), (I-746)+(1.086)+(7.002), (I-746)+(1.086)+(7.003), (I-746)+(1.086)+(7.004), (I-746)+(1.086)+(7.005), (I-746)+(1.086)+(7.006), (I-746)+(1.086)+(9.001), (I-746)+(1.086)+(9.002), (I-746)+(1.086)+(9.003), (I-746)+(1.086)+(9.004), (I-746)+(1.086)+(9.005), (I-746)+(1.086)+(9.006), (I-746)+(1.086)+(9.007), (I-746)+(1.086)+(9.008), (I-746)+(1.086)+(9.009), (I-746)+(1.086)+(14.001), (I-746)+(1.086)+(14.002), (I-746)+(1.086)+(15.008), (I-746)+(1.086)+(15.011), (I-746)+(1.086)+(15.012), (I-746)+(1.086)+(15.016), (I-746)+(1.086)+(15.025), (I-746)+(1.086)+(15.027), (I-746)+(1.086)+(15.047), (I-746)+(1.086)+(15.063), (I-746)+(1.086)+(15.064), (I-746)+(1.086)+(16.001), (I-746)+(1.086)+(16.002), (I-746)+(1.086)+(16.003), (I-746)+(1.086)+(16.004), (I-746)+(1.086)+(16.005), (I-746)+(1.086)+(16.006), (I-746)+(1.086)+(16.007), (I-746)+(1.086)+(16.008), (I-746)+(1.086)+(17.001), (I-746)+(1.086)+(17.002), (I-746)+(1.086)+(17.003), (I-746)+(1.086)+(17.004), (I-746)+(1.086)+(17.005), (I-746)+(1.086)+(17.006), (I-746)+(1.086)+(17.007), (I-746)+(1.086)+(17.008), (I-746)+(1.086)+(17.009), (I-746)+(1.086)+(17.010), (I-746)+(1.086)+(17.011), (I-746)+(1.086)+(17.012), (I-746)+(1.086)+(18.001),

(I-746)+(1.087)+(1.088), (I-746)+(1.087)+(1.089), (I-746)+(1.087)+(1.090), (I-746)+(1.087)+(1.091), (I-746)+(1.087)+(1.092), (I-746)+(1.087)+(2.001), (I-746)+(1.087)+(2.002), (I-746)+(1.087)+(2.003), (I-746)+(1.087)+(2.004), (I-746)+(1.087)+(2.005), (I-746)+(1.087)+(2.006), (I-746)+(1.087)+(2.007), (I-746)+(1.087)+(2.008), (I-746)+(1.087)+(2.009), (I-746)+(1.087)+(2.010), (I-746)+(1.087)+(2.011), (I-746)+(1.087)+(2.012), (I-746)+(1.087)+(2.013), (I-746)+(1.087)+(2.014), (I-746)+(1.087)+(2.015), (I-746)+(1.087)+(2.016), (I-746)+(1.087)+(2.017), (I-746)+(1.087)+(2.018), (I-746)+(1.087)+(2.019), (I-746)+(1.087)+(2.020), (I-746)+(1.087)+(2.021), (I-746)+(1.087)+(2.022), (I-746)+(1.087)+(2.023), (I-746)+(1.087)+(2.024), (I-746)+(1.087)+(2.025), (I-746)+(1.087)+(2.026), (I-746)+(1.087)+(2.027), (I-746)+(1.087)+(2.028), (I-746)+(1.087)+(2.029), (I-746)+(1.087)+(2.030), (I-746)+(1.087)+(2.031), (I-746)+(1.087)+(2.032), (I-746)+(1.087)+(2.033), (I-746)+(1.087)+(2.034), (I-746)+(1.087)+(2.035), (I-746)+(1.087)+(2.036), (I-746)+(1.087)+(2.037), (I-746)+(1.087)+(2.038), (I-746)+(1.087)+(2.039), (I-746)+(1.087)+(2.040), (I-746)+(1.087)+(2.041), (I-746)+(1.087)+(2.042), (I-746)+(1.087)+(2.043), (I-746)+(1.087)+(2.044), (I-746)+(1.087)+(2.045), (I-746)+(1.087)+(2.046), (I-746)+(1.087)+(2.047), (I-746)+(1.087)+(2.048), (I-746)+(1.087)+(2.049), (I-746)+(1.087)+(2.050), (I-746)+(1.087)+(2.051), (I-746)+(1.087)+(2.052), (I-746)+(1.087)+(2.053), (I-746)+(1.087)+(2.054), (I-746)+(1.087)+(2.055), (I-746)+(1.087)+(2.056), (I-746)+(1.087)+(2.057), (I-746)+(1.087)+(2.058), (I-746)+(1.087)+(2.059), (I-746)+(1.087)+(3.001), (I-746)+(1.087)+(3.002), (I-746)+(1.087)+(3.003), (I-746)+(1.087)+(3.004), (I-746)+(1.087)+(3.005), (I-746)+(1.087)+(3.006), (I-746)+(1.087)+(3.007), (I-746)+(1.087)+(3.008), (I-746)+(1.087)+(3.009), (I-746)+(1.087)+(3.010), (I-746)+(1.087)+(3.011), (I-746)+(1.087)+(3.012), (I-746)+(1.087)+(3.013), (I-746)+(1.087)+(3.014), (I-746)+(1.087)+(3.015), (I-746)+(1.087)+(3.016), (I-746)+(1.087)+(3.017), (I-746)+(1.087)+(3.018), (I-746)+(1.087)+(3.019), (I-746)+(1.087)+(3.020), (I-746)+(1.087)+(3.021), (I-746)+(1.087)+(3.022), (I-746)+(1.087)+(3.023), (I-746)+(1.087)+(3.024), (I-746)+(1.087)+(3.025), (I-746)+(1.087)+(3.026), (I-746)+(1.087)+(3.027), (I-746)+(1.087)+(3.028), (I-746)+(1.087)+(3.029), (I-746)+(1.087)+(3.030), (I-746)+(1.087)+(3.031), (I-746)+(1.087)+(5.001), (I-746)+(1.087)+(5.002), (I-746)+(1.087)+(5.003), (I-746)+(1.087)+(5.004), (I-746)+(1.087)+(5.005), (I-746)+(1.087)+(5.006), (I-746)+(1.087)+(5.007), (I-746)+(1.087)+(5.008), (I-746)+(1.087)+(5.009), (I-746)+(1.087)+(5.010), (I-746)+(1.087)+(5.011), (I-746)+(1.087)+(5.012), (I-746)+(1.087)+(5.013), (I-746)+(1.087)+(5.014), (I-746)+(1.087)+(5.015), (I-746)+(1.087)+(5.016), (I-746)+(1.087)+(5.017), (I-746)+(1.087)+(5.018), (I-746)+(1.087)+(5.019), (I-746)+(1.087)+(5.020), (I-746)+(1.087)+(5.021), (I-746)+(1.087)+(5.022), (I-746)+(1.087)+(5.023), (I-746)+(1.087)+(6.001), (I-746)+(1.087)+(6.002), (I-746)+(1.087)+(6.003), (I-746)+(1.087)+(6.004), (I-746)+(1.087)+(7.001), (I-746)+(1.087)+(7.002), (I-746)+(1.087)+(7.003), (I-746)+(1.087)+(7.004), (I-746)+(1.087)+(7.005), (I-746)+(1.087)+(7.006), (I-746)+(1.087)+(9.001), (I-746)+(1.087)+(9.002), (I-746)+(1.087)+(9.003), (I-746)+(1.087)+(9.004), (I-746)+(1.087)+(9.005), (I-746)+(1.087)+(9.006), (I-746)+(1.087)+(9.007), (I-746)+(1.087)+(9.008), (I-746)+(1.087)+(9.009), (I-746)+(1.087)+(14.001), (I-746)+(1.087)+(14.002), (I-746)+(1.087)+(15.008), (I-746)+(1.087)+(15.011), (I-746)+(1.087)+(15.012), (I-746)+(1.087)+(15.016), (I-746)+(1.087)+(15.025), (I-746)+(1.087)+(15.027), (I-746)+(1.087)+(15.047), (I-746)+(1.087)+(15.063), (I-746)+(1.087)+(15.064), (I-746)+(1.087)+(16.001), (I-746)+(1.087)+(16.002), (I-746)+(1.087)+(16.003), (I-746)+(1.087)+(16.004), (I-746)+(1.087)+(16.005), (I-746)+(1.087)+(16.006), (I-746)+(1.087)+(16.007), (I-746)+(1.087)+(16.008), (I-746)+(1.087)+(17.001), (I-746)+(1.087)+(17.002), (I-746)+(1.087)+(17.003), (I-746)+(1.087)+(17.004), (I-746)+(1.087)+(17.005), (I-746)+(1.087)+(17.006), (I-746)+(1.087)+(17.007), (I-746)+(1.087)+(17.008), (I-746)+(1.087)+(17.009), (I-746)+(1.087)+(17.010), (I-746)+(1.087)+(17.011), (I-746)+(1.087)+(17.012), (I-746)+(1.087)+(18.001),

(I-746)+(1.088)+(1.089), (I-746)+(1.088)+(1.090), (I-746)+(1.088)+(1.091), (I-746)+(1.088)+(1.092), (I-746)+(1.088)+(2.001), (I-746)+(1.088)+(2.002), (I-746)+(1.088)+(2.003), (I-746)+(1.088)+(2.004), (I-746)+(1.088)+(2.005), (I-746)+(1.088)+(2.006), (I-746)+(1.088)+(2.007), (I-746)+(1.088)+(2.008), (I-746)+(1.088)+(2.009), (I-746)+(1.088)+(2.010), (I-746)+(1.088)+(2.011), (I-746)+(1.088)+(2.012), (I-746)+(1.088)+(2.013), (I-746)+(1.088)+(2.014), (I-746)+(1.088)+(2.015), (I-746)+(1.088)+(2.016), (I-746)+(1.088)+(2.017), (I-746)+(1.088)+(2.018), (I-746)+(1.088)+(2.019), (I-746)+(1.088)+(2.020), (I-746)+(1.088)+(2.021), (I-746)+(1.088)+(2.022), (I-746)+(1.088)+(2.023), (I-746)+(1.088)+(2.024), (I-746)+(1.088)+(2.025), (I-746)+(1.088)+(2.026), (I-746)+(1.088)+(2.027), (I-746)+(1.088)+(2.028), (I-746)+(1.088)+(2.029), (I-746)+(1.088)+(2.030), (I-746)+(1.088)+(2.031), (I-746)+(1.088)+(2.032), (I-746)+(1.088)+(2.033), (I-746)+(1.088)+(2.034), (I-746)+(1.088)+(2.035), (I-746)+(1.088)+(2.036), (I-746)+(1.088)+(2.037), (I-746)+(1.088)+(2.038), (I-746)+(1.088)+(2.039), (I-746)+(1.088)+(2.040), (I-746)+(1.088)+(2.041), (I-746)+(1.088)+(2.042), (I-746)+(1.088)+(2.043), (I-746)+(1.088)+(2.044), (I-746)+(1.088)+(2.045), (I-746)+(1.088)+(2.046), (I-746)+(1.088)+(2.047), (I-746)+(1.088)+(2.048), (I-746)+(1.088)+(2.049), (I-746)+(1.088)+(2.050), (I-746)+(1.088)+(2.051), (I-746)+(1.088)+(2.052), (I-746)+(1.088)+(2.053), (I-746)+(1.088)+(2.054), (I-746)+(1.088)+(2.055), (I-746)+(1.088)+(2.056), (I-746)+(1.088)+(2.057), (I-746)+(1.088)+(2.058), (I-746)+(1.088)+(2.059), (I-746)+(1.088)+(3.001), (I-746)+(1.088)+(3.002), (I-746)+(1.088)+(3.003), (I-746)+(1.088)+(3.004), (I-746)+(1.088)+(3.005), (I-746)+(1.088)+(3.006), (I-746)+(1.088)+(3.007), (I-746)+(1.088)+(3.008), (I-746)+(1.088)+(3.009), (I-746)+(1.088)+(3.010), (I-746)+(1.088)+(3.011), (I-746)+(1.088)+(3.012), (I-746)+(1.088)+(3.013), (I-746)+(1.088)+(3.014), (I-746)+(1.088)+(3.015), (I-746)+(1.088)+(3.016), (I-746)+(1.088)+(3.017), (I-746)+(1.088)+(3.018), (I-746)+(1.088)+(3.019), (I-746)+(1.088)+(3.020), (I-746)+(1.088)+(3.021), (I-746)+(1.088)+(3.022), (I-746)+(1.088)+(3.023), (I-746)+(1.088)+(3.024), (I-746)+(1.088)+(3.025), (I-746)+(1.088)+(3.026), (I-746)+(1.088)+(3.027), (I-746)+(1.088)+(3.028), (I-746)+(1.088)+(3.029), (I-746)+(1.088)+(3.030), (I-746)+(1.088)+(3.031), (I-746)+(1.088)+(5.001), (I-746)+(1.088)+(5.002), (I-746)+(1.088)+(5.003), (I-746)+(1.088)+(5.004), (I-746)+(1.088)+(5.005), (I-746)+(1.088)+(5.006), (I-746)+(1.088)+(5.007), (I-746)+(1.088)+(5.008), (I-746)+(1.088)+(5.009), (I-746)+(1.088)+(5.010), (I-746)+(1.088)+(5.011), (I-746)+(1.088)+(5.012), (I-746)+(1.088)+(5.013), (I-746)+(1.088)+(5.014), (I-746)+(1.088)+(5.015), (I-746)+(1.088)+(5.016), (I-746)+(1.088)+(5.017), (I-746)+(1.088)+(5.018), (I-746)+(1.088)+(5.019), (I-746)+(1.088)+(5.020), (I-746)+(1.088)+(5.021), (I-746)+(1.088)+(5.022), (I-746)+(1.088)+(5.023), (I-746)+(1.088)+(6.001), (I-746)+(1.088)+(6.002), (I-746)+(1.088)+(6.003), (I-746)+(1.088)+(6.004), (I-746)+(1.088)+(7.001), (I-746)+(1.088)+(7.002), (I-746)+(1.088)+(7.003), (I-746)+(1.088)+(7.004), (I-746)+(1.088)+(7.005), (I-746)+(1.088)+(7.006), (I-746)+(1.088)+(9.001), (I-746)+(1.088)+(9.002), (I-746)+(1.088)+(9.003), (I-746)+(1.088)+(9.004), (I-746)+(1.088)+(9.005), (I-746)+(1.088)+(9.006), (I-746)+(1.088)+(9.007), (I-746)+(1.088)+(9.008), (I-746)+(1.088)+(9.009), (I-746)+(1.088)+(14.001), (I-746)+(1.088)+(14.002), (I-746)+(1.088)+(15.008), (I-746)+(1.088)+(15.011), (I-746)+(1.088)+(15.012), (I-746)+(1.088)+(15.016), (I-746)+(1.088)+(15.025), (I-746)+(1.088)+(15.027), (I-746)+(1.088)+(15.047), (I-746)+(1.088)+(15.063), (I-746)+(1.088)+(15.064), (I-746)+(1.088)+(16.001), (I-746)+(1.088)+(16.002), (I-746)+(1.088)+(16.003), (I-746)+(1.088)+(16.004), (I-746)+(1.088)+(16.005), (I-746)+(1.088)+(16.006), (I-746)+(1.088)+(16.007), (I-746)+(1.088)+(16.008), (I-746)+(1.088)+(17.001), (I-746)+(1.088)+(17.002), (I-746)+(1.088)+(17.003), (I-746)+(1.088)+(17.004), (I-746)+(1.088)+(17.005), (I-746)+(1.088)+(17.006), (I-746)+(1.088)+(17.007), (I-746)+(1.088)+(17.008), (I-746)+(1.088)+(17.009), (I-746)+(1.088)+(17.010), (I-746)+(1.088)+(17.011), (I-746)+(1.088)+(17.012), (I-746)+(1.088)+(18.001),

(I-746)+(1.089)+(1.090), (I-746)+(1.089)+(1.091), (I-746)+(1.089)+(1.092), (I-746)+(1.089)+(2.001), (I-746)+(1.089)+(2.002), (I-746)+(1.089)+(2.003), (I-746)+(1.089)+(2.004), (I-746)+(1.089)+(2.005), (I-746)+(1.089)+(2.006), (I-746)+(1.089)+(2.007), (I-746)+(1.089)+(2.008), (I-746)+(1.089)+(2.009), (I-746)+(1.089)+(2.010), (I-746)+(1.089)+(2.011), (I-746)+(1.089)+(2.012), (I-746)+(1.089)+(2.013), (I-746)+(1.089)+(2.014), (I-746)+(1.089)+(2.015), (I-746)+(1.089)+(2.016), (I-746)+(1.089)+(2.017), (I-746)+(1.089)+(2.018), (I-746)+(1.089)+(2.019), (I-746)+(1.089)+(2.020), (I-746)+(1.089)+(2.021), (I-746)+(1.089)+(2.022), (I-746)+(1.089)+(2.023), (I-746)+(1.089)+(2.024), (I-746)+(1.089)+(2.025), (I-746)+(1.089)+(2.026), (I-746)+(1.089)+(2.027), (I-746)+(1.089)+(2.028), (I-746)+(1.089)+(2.029), (I-746)+(1.089)+(2.030), (I-746)+(1.089)+(2.031), (I-746)+(1.089)+(2.032), (I-746)+(1.089)+(2.033), (I-746)+(1.089)+(2.034), (I-746)+(1.089)+(2.035), (I-746)+(1.089)+(2.036), (I-746)+(1.089)+(2.037), (I-746)+(1.089)+(2.038), (I-746)+(1.089)+(2.039), (I-746)+(1.089)+(2.040), (I-746)+(1.089)+(2.041), (I-746)+(1.089)+(2.042), (I-746)+(1.089)+(2.043), (I-746)+(1.089)+(2.044), (I-746)+(1.089)+(2.045), (I-746)+(1.089)+(2.046), (I-746)+(1.089)+(2.047), (I-746)+(1.089)+(2.048), (I-746)+(1.089)+(2.049), (I-746)+(1.089)+(2.050), (I-746)+(1.089)+(2.051), (I-746)+(1.089)+(2.052), (I-746)+(1.089)+(2.053), (I-746)+(1.089)+(2.054), (I-746)+(1.089)+(2.055), (I-746)+(1.089)+(2.056), (I-746)+(1.089)+(2.057), (I-746)+(1.089)+(2.058), (I-746)+(1.089)+(2.059), (I-746)+(1.089)+(3.001), (I-746)+(1.089)+(3.002), (I-746)+(1.089)+(3.003), (I-746)+(1.089)+(3.004), (I-746)+(1.089)+(3.005), (I-746)+(1.089)+(3.006), (I-746)+(1.089)+(3.007), (I-746)+(1.089)+(3.008), (I-746)+(1.089)+(3.009), (I-746)+(1.089)+(3.010), (I-746)+(1.089)+(3.011), (I-746)+(1.089)+(3.012), (I-746)+(1.089)+(3.013), (I-746)+(1.089)+(3.014), (I-746)+(1.089)+(3.015), (I-746)+(1.089)+(3.016), (I-746)+(1.089)+(3.017), (I-746)+(1.089)+(3.018), (I-746)+(1.089)+(3.019), (I-746)+(1.089)+(3.020), (I-746)+(1.089)+(3.021), (I-746)+(1.089)+(3.022), (I-746)+(1.089)+(3.023), (I-746)+(1.089)+(3.024), (I-746)+(1.089)+(3.025), (I-746)+(1.089)+(3.026), (I-746)+(1.089)+(3.027), (I-746)+(1.089)+(3.028), (I-746)+(1.089)+(3.029), (I-746)+(1.089)+(3.030), (I-746)+(1.089)+(3.031), (I-746)+(1.089)+(5.001), (I-746)+(1.089)+(5.002), (I-746)+(1.089)+(5.003), (I-746)+(1.089)+(5.004), (I-746)+(1.089)+(5.005), (I-746)+(1.089)+(5.006), (I-746)+(1.089)+(5.007), (I-746)+(1.089)+(5.008), (I-746)+(1.089)+(5.009), (I-746)+(1.089)+(5.010), (I-746)+(1.089)+(5.011), (I-746)+(1.089)+(5.012), (I-746)+(1.089)+(5.013), (I-746)+(1.089)+(5.014), (I-746)+(1.089)+(5.015), (I-746)+(1.089)+(5.016), (I-746)+(1.089)+(5.017), (I-746)+(1.089)+(5.018), (I-746)+(1.089)+(5.019), (I-746)+(1.089)+(5.020), (I-746)+(1.089)+(5.021), (I-746)+(1.089)+(5.022), (I-746)+(1.089)+(5.023), (I-746)+(1.089)+(6.001), (I-746)+(1.089)+(6.002), (I-746)+(1.089)+(6.003), (I-746)+(1.089)+(6.004), (I-746)+(1.089)+(7.001), (I-746)+(1.089)+(7.002), (I-746)+(1.089)+(7.003), (I-746)+(1.089)+(7.004), (I-746)+(1.089)+(7.005), (I-746)+(1.089)+(7.006), (I-746)+(1.089)+(9.001), (I-746)+(1.089)+(9.002), (I-746)+(1.089)+(9.003), (I-746)+(1.089)+(9.004), (I-746)+(1.089)+(9.005), (I-746)+(1.089)+(9.006), (I-746)+(1.089)+(9.007), (I-746)+(1.089)+(9.008), (I-746)+(1.089)+(9.009), (I-746)+(1.089)+(14.001), (I-746)+(1.089)+(14.002), (I-746)+(1.089)+(15.008), (I-746)+(1.089)+(15.011), (I-746)+(1.089)+(15.012), (I-746)+(1.089)+(15.016), (I-746)+(1.089)+(15.025), (I-746)+(1.089)+(15.027), (I-746)+(1.089)+(15.047), (I-746)+(1.089)+(15.063), (I-746)+(1.089)+(15.064), (I-746)+(1.089)+(16.001), (I-746)+(1.089)+(16.002), (I-746)+(1.089)+(16.003), (I-746)+(1.089)+(16.004), (I-746)+(1.089)+(16.005), (I-746)+(1.089)+(16.006), (I-746)+(1.089)+(16.007), (I-746)+(1.089)+(16.008), (I-746)+(1.089)+(17.001), (I-746)+(1.089)+(17.002), (I-746)+(1.089)+(17.003), (I-746)+(1.089)+(17.004), (I-746)+(1.089)+(17.005), (I-746)+(1.089)+(17.006), (I-746)+(1.089)+(17.007), (I-746)+(1.089)+(17.008), (I-746)+(1.089)+(17.009), (I-746)+(1.089)+(17.010), (I-746)+(1.089)+(17.011), (I-746)+(1.089)+(17.012), (I-746)+(1.089)+(18.001),

(I-746)+(1.090)+(1.091), (I-746)+(1.090)+(1.092), (I-746)+(1.090)+(2.001), (I-746)+(1.090)+(2.002), (I-746)+(1.090)+(2.003), (I-746)+(1.090)+(2.004), (I-746)+(1.090)+(2.005), (I-746)+(1.090)+(2.006), (I-746)+(1.090)+(2.007), (I-746)+(1.090)+(2.008), (I-746)+(1.090)+(2.009), (I-746)+(1.090)+(2.010), (I-746)+(1.090)+(2.011), (I-746)+(1.090)+(2.012), (I-746)+(1.090)+(2.013), (I-746)+(1.090)+(2.014), (I-746)+(1.090)+(2.015), (I-746)+(1.090)+(2.016), (I-746)+(1.090)+(2.017), (I-746)+(1.090)+(2.018), (I-746)+(1.090)+(2.019), (I-746)+(1.090)+(2.020), (I-746)+(1.090)+(2.021), (I-746)+(1.090)+(2.022), (I-746)+(1.090)+(2.023), (I-746)+(1.090)+(2.024), (I-746)+(1.090)+(2.025), (I-746)+(1.090)+(2.026), (I-746)+(1.090)+(2.027), (I-746)+(1.090)+(2.028), (I-746)+(1.090)+(2.029), (I-746)+(1.090)+(2.030), (I-746)+(1.090)+(2.031), (I-746)+(1.090)+(2.032), (I-746)+(1.090)+(2.033), (I-746)+(1.090)+(2.034), (I-746)+(1.090)+(2.035), (I-746)+(1.090)+(2.036), (I-746)+(1.090)+(2.037), (I-746)+(1.090)+(2.038), (I-746)+(1.090)+(2.039), (I-746)+(1.090)+(2.040), (I-746)+(1.090)+(2.041), (I-746)+(1.090)+(2.042), (I-746)+(1.090)+(2.043), (I-746)+(1.090)+(2.044), (I-746)+(1.090)+(2.045), (I-746)+(1.090)+(2.046), (I-746)+(1.090)+(2.047), (I-746)+(1.090)+(2.048), (I-746)+(1.090)+(2.049), (I-746)+(1.090)+(2.050), (I-746)+(1.090)+(2.051), (I-746)+(1.090)+(2.052), (I-746)+(1.090)+(2.053), (I-746)+(1.090)+(2.054), (I-746)+(1.090)+(2.055), (I-746)+(1.090)+(2.056), (I-746)+(1.090)+(2.057), (I-746)+(1.090)+(2.058), (I-746)+(1.090)+(2.059), (I-746)+(1.090)+(3.001), (I-746)+(1.090)+(3.002), (I-746)+(1.090)+(3.003), (I-746)+(1.090)+(3.004), (I-746)+(1.090)+(3.005), (I-746)+(1.090)+(3.006), (I-746)+(1.090)+(3.007), (I-746)+(1.090)+(3.008), (I-746)+(1.090)+(3.009), (I-746)+(1.090)+(3.010), (I-746)+(1.090)+(3.011), (I-746)+(1.090)+(3.012), (I-746)+(1.090)+(3.013), (I-746)+(1.090)+(3.014), (I-746)+(1.090)+(3.015), (I-746)+(1.090)+(3.016), (I-746)+(1.090)+(3.017), (I-746)+(1.090)+(3.018), (I-746)+(1.090)+(3.019), (I-746)+(1.090)+(3.020), (I-746)+(1.090)+(3.021), (I-746)+(1.090)+(3.022), (I-746)+(1.090)+(3.023), (I-746)+(1.090)+(3.024), (I-746)+(1.090)+(3.025), (I-746)+(1.090)+(3.026), (I-746)+(1.090)+(3.027), (I-746)+(1.090)+(3.028), (I-746)+(1.090)+(3.029), (I-746)+(1.090)+(3.030), (I-746)+(1.090)+(3.031), (I-746)+(1.090)+(5.001), (I-746)+(1.090)+(5.002), (I-746)+(1.090)+(5.003), (I-746)+(1.090)+(5.004), (I-746)+(1.090)+(5.005), (I-746)+(1.090)+(5.006), (I-746)+(1.090)+(5.007), (I-746)+(1.090)+(5.008), (I-746)+(1.090)+(5.009), (I-746)+(1.090)+(5.010), (I-746)+(1.090)+(5.011), (I-746)+(1.090)+(5.012), (I-746)+(1.090)+(5.013), (I-746)+(1.090)+(5.014), (I-746)+(1.090)+(5.015), (I-746)+(1.090)+(5.016), (I-746)+(1.090)+(5.017), (I-746)+(1.090)+(5.018), (I-746)+(1.090)+(5.019), (I-746)+(1.090)+(5.020), (I-746)+(1.090)+(5.021), (I-746)+(1.090)+(5.022), (I-746)+(1.090)+(5.023), (I-746)+(1.090)+(6.001), (I-746)+(1.090)+(6.002), (I-746)+(1.090)+(6.003), (I-746)+(1.090)+(6.004), (I-746)+(1.090)+(7.001), (I-746)+(1.090)+(7.002), (I-746)+(1.090)+(7.003), (I-746)+(1.090)+(7.004), (I-746)+(1.090)+(7.005), (I-746)+(1.090)+(7.006), (I-746)+(1.090)+(9.001), (I-746)+(1.090)+(9.002), (I-746)+(1.090)+(9.003), (I-746)+(1.090)+(9.004), (I-746)+(1.090)+(9.005), (I-746)+(1.090)+(9.006), (I-746)+(1.090)+(9.007), (I-746)+(1.090)+(9.008), (I-746)+(1.090)+(9.009), (I-746)+(1.090)+(14.001), (I-746)+(1.090)+(14.002), (I-746)+(1.090)+(15.008), (I-746)+(1.090)+(15.011), (I-746)+(1.090)+(15.012), (I-746)+(1.090)+(15.016), (I-746)+(1.090)+(15.025), (I-746)+(1.090)+(15.027), (I-746)+(1.090)+(15.047), (I-746)+(1.090)+(15.063), (I-746)+(1.090)+(15.064), (I-746)+(1.090)+(16.001), (I-746)+(1.090)+(16.002), (I-746)+(1.090)+(16.003), (I-746)+(1.090)+(16.004), (I-746)+(1.090)+(16.005), (I-746)+(1.090)+(16.006), (I-746)+(1.090)+(16.007), (I-746)+(1.090)+(16.008), (I-746)+(1.090)+(17.001), (I-746)+(1.090)+(17.002), (I-746)+(1.090)+(17.003), (I-746)+(1.090)+(17.004), (I-746)+(1.090)+(17.005), (I-746)+(1.090)+(17.006), (I-746)+(1.090)+(17.007), (I-746)+(1.090)+(17.008), (I-746)+(1.090)+(17.009), (I-746)+(1.090)+(17.010), (I-746)+(1.090)+(17.011), (I-746)+(1.090)+(17.012), (I-746)+(1.090)+(18.001),

(I-746)+(1.091)+(1.092), (I-746)+(1.091)+(2.001), (I-746)+(1.091)+(2.002), (I-746)+(1.091)+(2.003), (I-746)+(1.091)+(2.004), (I-746)+(1.091)+(2.005), (I-746)+(1.091)+(2.006), (I-746)+(1.091)+(2.007), (I-746)+(1.091)+(2.008), (I-746)+(1.091)+(2.009), (I-746)+(1.091)+(2.010), (I-746)+(1.091)+(2.011), (I-746)+(1.091)+(2.012), (I-746)+(1.091)+(2.013), (I-746)+(1.091)+(2.014), (I-746)+(1.091)+(2.015), (I-746)+(1.091)+(2.016), (I-746)+(1.091)+(2.017), (I-746)+(1.091)+(2.018), (I-746)+(1.091)+(2.019), (I-746)+(1.091)+(2.020), (I-746)+(1.091)+(2.021), (I-746)+(1.091)+(2.022), (I-746)+(1.091)+(2.023), (I-746)+(1.091)+(2.024), (I-746)+(1.091)+(2.025), (I-746)+(1.091)+(2.026), (I-746)+(1.091)+(2.027), (I-746)+(1.091)+(2.028), (I-746)+(1.091)+(2.029), (I-746)+(1.091)+(2.030), (I-746)+(1.091)+(2.031), (I-746)+(1.091)+(2.032), (I-746)+(1.091)+(2.033), (I-746)+(1.091)+(2.034), (I-746)+(1.091)+(2.035), (I-746)+(1.091)+(2.036), (I-746)+(1.091)+(2.037), (I-746)+(1.091)+(2.038), (I-746)+(1.091)+(2.039), (I-746)+(1.091)+(2.040), (I-746)+(1.091)+(2.041), (I-746)+(1.091)+(2.042), (I-746)+(1.091)+(2.043), (I-746)+(1.091)+(2.044), (I-746)+(1.091)+(2.045), (I-746)+(1.091)+(2.046), (I-746)+(1.091)+(2.047), (I-746)+(1.091)+(2.048), (I-746)+(1.091)+(2.049), (I-746)+(1.091)+(2.050), (I-746)+(1.091)+(2.051), (I-746)+(1.091)+(2.052), (I-746)+(1.091)+(2.053), (I-746)+(1.091)+(2.054), (I-746)+(1.091)+(2.055), (I-746)+(1.091)+(2.056), (I-746)+(1.091)+(2.057), (I-746)+(1.091)+(2.058), (I-746)+(1.091)+(2.059), (I-746)+(1.091)+(3.001), (I-746)+(1.091)+(3.002), (I-746)+(1.091)+(3.003), (I-746)+(1.091)+(3.004), (I-746)+(1.091)+(3.005), (I-746)+(1.091)+(3.006), (I-746)+(1.091)+(3.007), (I-746)+(1.091)+(3.008), (I-746)+(1.091)+(3.009), (I-746)+(1.091)+(3.010), (I-746)+(1.091)+(3.011), (I-746)+(1.091)+(3.012), (I-746)+(1.091)+(3.013), (I-746)+(1.091)+(3.014), (I-746)+(1.091)+(3.015), (I-746)+(1.091)+(3.016), (I-746)+(1.091)+(3.017), (I-746)+(1.091)+(3.018), (I-746)+(1.091)+(3.019), (I-746)+(1.091)+(3.020), (I-746)+(1.091)+(3.021), (I-746)+(1.091)+(3.022), (I-746)+(1.091)+(3.023), (I-746)+(1.091)+(3.024), (I-746)+(1.091)+(3.025), (I-746)+(1.091)+(3.026), (I-746)+(1.091)+(3.027), (I-746)+(1.091)+(3.028), (I-746)+(1.091)+(3.029), (I-746)+(1.091)+(3.030), (I-746)+(1.091)+(3.031), (I-746)+(1.091)+(5.001), (I-746)+(1.091)+(5.002), (I-746)+(1.091)+(5.003), (I-746)+(1.091)+(5.004), (I-746)+(1.091)+(5.005), (I-746)+(1.091)+(5.006), (I-746)+(1.091)+(5.007), (I-746)+(1.091)+(5.008), (I-746)+(1.091)+(5.009), (I-746)+(1.091)+(5.010), (I-746)+(1.091)+(5.011), (I-746)+(1.091)+(5.012), (I-746)+(1.091)+(5.013), (I-746)+(1.091)+(5.014), (I-746)+(1.091)+(5.015), (I-746)+(1.091)+(5.016), (I-746)+(1.091)+(5.017), (I-746)+(1.091)+(5.018), (I-746)+(1.091)+(5.019), (I-746)+(1.091)+(5.020), (I-746)+(1.091)+(5.021), (I-746)+(1.091)+(5.022), (I-746)+(1.091)+(5.023), (I-746)+(1.091)+(6.001), (I-746)+(1.091)+(6.002), (I-746)+(1.091)+(6.003), (I-746)+(1.091)+(6.004), (I-746)+(1.091)+(7.001), (I-746)+(1.091)+(7.002), (I-746)+(1.091)+(7.003), (I-746)+(1.091)+(7.004), (I-746)+(1.091)+(7.005), (I-746)+(1.091)+(7.006), (I-746)+(1.091)+(9.001), (I-746)+(1.091)+(9.002), (I-746)+(1.091)+(9.003), (I-746)+(1.091)+(9.004), (I-746)+(1.091)+(9.005), (I-746)+(1.091)+(9.006), (I-746)+(1.091)+(9.007), (I-746)+(1.091)+(9.008), (I-746)+(1.091)+(9.009), (I-746)+(1.091)+(14.001), (I-746)+(1.091)+(14.002), (I-746)+(1.091)+(15.008), (I-746)+(1.091)+(15.011), (I-746)+(1.091)+(15.012), (I-746)+(1.091)+(15.016), (I-746)+(1.091)+(15.025), (I-746)+(1.091)+(15.027), (I-746)+(1.091)+(15.047), (I-746)+(1.091)+(15.063), (I-746)+(1.091)+(15.064), (I-746)+(1.091)+(16.001), (I-746)+(1.091)+(16.002), (I-746)+(1.091)+(16.003), (I-746)+(1.091)+(16.004), (I-746)+(1.091)+(16.005), (I-746)+(1.091)+(16.006), (I-746)+(1.091)+(16.007), (I-746)+(1.091)+(16.008), (I-746)+(1.091)+(17.001), (I-746)+(1.091)+(17.002), (I-746)+(1.091)+(17.003), (I-746)+(1.091)+(17.004), (I-746)+(1.091)+(17.005), (I-746)+(1.091)+(17.006), (I-746)+(1.091)+(17.007), (I-746)+(1.091)+(17.008), (I-746)+(1.091)+(17.009), (I-746)+(1.091)+(17.010), (I-746)+(1.091)+(17.011), (I-746)+(1.091)+(17.012), (I-746)+(1.091)+(18.001),

(I-746)+(1.092)+(2.001), (I-746)+(1.092)+(2.002), (I-746)+(1.092)+(2.003), (I-746)+(1.092)+(2.004), (I-746)+(1.092)+(2.005), (I-746)+(1.092)+(2.006), (I-746)+(1.092)+(2.007), (I-746)+(1.092)+(2.008), (I-746)+(1.092)+(2.009), (I-746)+(1.092)+(2.010), (I-746)+(1.092)+(2.011), (I-746)+(1.092)+(2.012), (I-746)+(1.092)+(2.013), (I-746)+(1.092)+(2.014), (I-746)+(1.092)+(2.015), (I-746)+(1.092)+(2.016), (I-746)+(1.092)+(2.017), (I-746)+(1.092)+(2.018), (I-746)+(1.092)+(2.019), (I-746)+(1.092)+(2.020), (I-746)+(1.092)+(2.021), (I-746)+(1.092)+(2.022), (I-746)+(1.092)+(2.023), (I-746)+(1.092)+(2.024), (I-746)+(1.092)+(2.025), (I-746)+(1.092)+(2.026), (I-746)+(1.092)+(2.027), (I-746)+(1.092)+(2.028), (I-746)+(1.092)+(2.029), (I-746)+(1.092)+(2.030), (I-746)+(1.092)+(2.031), (I-746)+(1.092)+(2.032), (I-746)+(1.092)+(2.033), (I-746)+(1.092)+(2.034), (I-746)+(1.092)+(2.035), (I-746)+(1.092)+(2.036), (I-746)+(1.092)+(2.037), (I-746)+(1.092)+(2.038), (I-746)+(1.092)+(2.039), (I-746)+(1.092)+(2.040), (I-746)+(1.092)+(2.041), (I-746)+(1.092)+(2.042), (I-746)+(1.092)+(2.043), (I-746)+(1.092)+(2.044), (I-746)+(1.092)+(2.045), (I-746)+(1.092)+(2.046), (I-746)+(1.092)+(2.047), (I-746)+(1.092)+(2.048), (I-746)+(1.092)+(2.049), (I-746)+(1.092)+(2.050), (I-746)+(1.092)+(2.051), (I-746)+(1.092)+(2.052), (I-746)+(1.092)+(2.053), (I-746)+(1.092)+(2.054), (I-746)+(1.092)+(2.055), (I-746)+(1.092)+(2.056), (I-746)+(1.092)+(2.057), (I-746)+(1.092)+(2.058), (I-746)+(1.092)+(2.059), (I-746)+(1.092)+(3.001), (I-746)+(1.092)+(3.002), (I-746)+(1.092)+(3.003), (I-746)+(1.092)+(3.004), (I-746)+(1.092)+(3.005), (I-746)+(1.092)+(3.006), (I-746)+(1.092)+(3.007), (I-746)+(1.092)+(3.008), (I-746)+(1.092)+(3.009), (I-746)+(1.092)+(3.010), (I-746)+(1.092)+(3.011), (I-746)+(1.092)+(3.012), (I-746)+(1.092)+(3.013), (I-746)+(1.092)+(3.014), (I-746)+(1.092)+(3.015), (I-746)+(1.092)+(3.016), (I-746)+(1.092)+(3.017), (I-746)+(1.092)+(3.018), (I-746)+(1.092)+(3.019), (I-746)+(1.092)+(3.020), (I-746)+(1.092)+(3.021), (I-746)+(1.092)+(3.022), (I-746)+(1.092)+(3.023), (I-746)+(1.092)+(3.024), (I-746)+(1.092)+(3.025), (I-746)+(1.092)+(3.026), (I-746)+(1.092)+(3.027), (I-746)+(1.092)+(3.028), (I-746)+(1.092)+(3.029), (I-746)+(1.092)+(3.030), (I-746)+(1.092)+(3.031), (I-746)+(1.092)+(5.001), (I-746)+(1.092)+(5.002), (I-746)+(1.092)+(5.003), (I-746)+(1.092)+(5.004), (I-746)+(1.092)+(5.005), (I-746)+(1.092)+(5.006), (I-746)+(1.092)+(5.007), (I-746)+(1.092)+(5.008), (I-746)+(1.092)+(5.009), (I-746)+(1.092)+(5.010), (I-746)+(1.092)+(5.011), (I-746)+(1.092)+(5.012), (I-746)+(1.092)+(5.013), (I-746)+(1.092)+(5.014), (I-746)+(1.092)+(5.015), (I-746)+(1.092)+(5.016), (I-746)+(1.092)+(5.017), (I-746)+(1.092)+(5.018), (I-746)+(1.092)+(5.019), (I-746)+(1.092)+(5.020), (I-746)+(1.092)+(5.021), (I-746)+(1.092)+(5.022), (I-746)+(1.092)+(5.023), (I-746)+(1.092)+(6.001), (I-746)+(1.092)+(6.002), (I-746)+(1.092)+(6.003), (I-746)+(1.092)+(6.004), (I-746)+(1.092)+(7.001), (I-746)+(1.092)+(7.002), (I-746)+(1.092)+(7.003), (I-746)+(1.092)+(7.004), (I-746)+(1.092)+(7.005), (I-746)+(1.092)+(7.006), (I-746)+(1.092)+(9.001), (I-746)+(1.092)+(9.002), (I-746)+(1.092)+(9.003), (I-746)+(1.092)+(9.004), (I-746)+(1.092)+(9.005), (I-746)+(1.092)+(9.006), (I-746)+(1.092)+(9.007), (I-746)+(1.092)+(9.008), (I-746)+(1.092)+(9.009), (I-746)+(1.092)+(14.001), (I-746)+(1.092)+(14.002), (I-746)+(1.092)+(15.008), (I-746)+(1.092)+(15.011), (I-746)+(1.092)+(15.012), (I-746)+(1.092)+(15.016), (I-746)+(1.092)+(15.025), (I-746)+(1.092)+(15.027), (I-746)+(1.092)+(15.047), (I-746)+(1.092)+(15.063), (I-746)+(1.092)+(15.064), (I-746)+(1.092)+(16.001), (I-746)+(1.092)+(16.002), (I-746)+(1.092)+(16.003), (I-746)+(1.092)+(16.004), (I-746)+(1.092)+(16.005), (I-746)+(1.092)+(16.006), (I-746)+(1.092)+(16.007), (I-746)+(1.092)+(16.008), (I-746)+(1.092)+(17.001), (I-746)+(1.092)+(17.002), (I-746)+(1.092)+(17.003), (I-746)+(1.092)+(17.004), (I-746)+(1.092)+(17.005), (I-746)+(1.092)+(17.006), (I-746)+(1.092)+(17.007), (I-746)+(1.092)+(17.008), (I-746)+(1.092)+(17.009), (I-746)+(1.092)+(17.010), (I-746)+(1.092)+(17.011), (I-746)+(1.092)+(17.012), (I-746)+(1.092)+(18.001),

(I-746)+(2.001)+(3.001), (I-746)+(2.001)+(3.002), (I-746)+(2.001)+(3.003), (I-746)+(2.001)+(3.004), (I-746)+(2.001)+(3.005), (I-746)+(2.001)+(3.006), (I-746)+(2.001)+(3.007), (I-746)+(2.001)+(3.008), (I-746)+(2.001)+(3.009), (I-746)+(2.001)+(3.010), (I-746)+(2.001)+(3.011), (I-746)+(2.001)+(3.012), (I-746)+(2.001)+(3.013), (I-746)+(2.001)+(3.014), (I-746)+(2.001)+(3.015), (I-746)+(2.001)+(3.016), (I-746)+(2.001)+(3.017), (I-746)+(2.001)+(3.018), (I-746)+(2.001)+(3.019), (I-746)+(2.001)+(3.020), (I-746)+(2.001)+(3.021), (I-746)+(2.001)+(3.022), (I-746)+(2.001)+(3.023), (I-746)+(2.001)+(3.024), (I-746)+(2.001)+(3.025), (I-746)+(2.001)+(3.026), (I-746)+(2.001)+(3.027), (I-746)+(2.001)+(3.028), (I-746)+(2.001)+(3.029), (I-746)+(2.001)+(3.030), (I-746)+(2.001)+(3.031), (I-746)+(2.001)+(5.001), (I-746)+(2.001)+(5.002), (I-746)+(2.001)+(5.003), (I-746)+(2.001)+(5.004), (I-746)+(2.001)+(5.005), (I-746)+(2.001)+(5.006), (I-746)+(2.001)+(5.007), (I-746)+(2.001)+(5.008), (I-746)+(2.001)+(5.009), (I-746)+(2.001)+(5.010), (I-746)+(2.001)+(5.011), (I-746)+(2.001)+(5.012), (I-746)+(2.001)+(5.013), (I-746)+(2.001)+(5.014), (I-746)+(2.001)+(5.015), (I-746)+(2.001)+(5.016), (I-746)+(2.001)+(5.017), (I-746)+(2.001)+(5.018), (I-746)+(2.001)+(5.019), (I-746)+(2.001)+(5.020), (I-746)+(2.001)+(5.021), (I-746)+(2.001)+(5.022), (I-746)+(2.001)+(5.023), (I-746)+(2.001)+(6.001), (I-746)+(2.001)+(6.002), (I-746)+(2.001)+(6.003), (I-746)+(2.001)+(6.004), (I-746)+(2.001)+(7.001), (I-746)+(2.001)+(7.002), (I-746)+(2.001)+(7.003), (I-746)+(2.001)+(7.004), (I-746)+(2.001)+(7.005), (I-746)+(2.001)+(7.006), (I-746)+(2.001)+(9.001), (I-746)+(2.001)+(9.002), (I-746)+(2.001)+(9.003), (I-746)+(2.001)+(9.004), (I-746)+(2.001)+(9.005), (I-746)+(2.001)+(9.006), (I-746)+(2.001)+(9.007), (I-746)+(2.001)+(9.008), (I-746)+(2.001)+(9.009), (I-746)+(2.001)+(14.001), (I-746)+(2.001)+(14.002), (I-746)+(2.001)+(15.008), (I-746)+(2.001)+(15.011), (I-746)+(2.001)+(15.012), (I-746)+(2.001)+(15.016), (I-746)+(2.001)+(15.025), (I-746)+(2.001)+(15.027), (I-746)+(2.001)+(15.047), (I-746)+(2.001)+(15.063), (I-746)+(2.001)+(15.064), (I-746)+(2.001)+(16.001), (I-746)+(2.001)+(16.002), (I-746)+(2.001)+(16.003), (I-746)+(2.001)+(16.004), (I-746)+(2.001)+(16.005), (I-746)+(2.001)+(16.006), (I-746)+(2.001)+(16.007), (I-746)+(2.001)+(16.008), (I-746)+(2.001)+(17.001), (I-746)+(2.001)+(17.002), (I-746)+(2.001)+(17.003), (I-746)+(2.001)+(17.004), (I-746)+(2.001)+(17.005), (I-746)+(2.001)+(17.006), (I-746)+(2.001)+(17.007), (I-746)+(2.001)+(17.008), (I-746)+(2.001)+(17.009), (I-746)+(2.001)+(17.010), (I-746)+(2.001)+(17.011), (I-746)+(2.001)+(17.012), (I-746)+(2.001)+(18.001),

(I-746)+(2.002)+(3.001), (I-746)+(2.002)+(3.002), (I-746)+(2.002)+(3.003), (I-746)+(2.002)+(3.004), (I-746)+(2.002)+(3.005), (I-746)+(2.002)+(3.006), (I-746)+(2.002)+(3.007), (I-746)+(2.002)+(3.008), (I-746)+(2.002)+(3.009), (I-746)+(2.002)+(3.010), (I-746)+(2.002)+(3.011), (I-746)+(2.002)+(3.012), (I-746)+(2.002)+(3.013), (I-746)+(2.002)+(3.014), (I-746)+(2.002)+(3.015), (I-746)+(2.002)+(3.016), (I-746)+(2.002)+(3.017), (I-746)+(2.002)+(3.018), (I-746)+(2.002)+(3.019), (I-746)+(2.002)+(3.020), (I-746)+(2.002)+(3.021), (I-746)+(2.002)+(3.022), (I-746)+(2.002)+(3.023), (I-746)+(2.002)+(3.024), (I-746)+(2.002)+(3.025), (I-746)+(2.002)+(3.026), (I-746)+(2.002)+(3.027), (I-746)+(2.002)+(3.028), (I-746)+(2.002)+(3.029), (I-746)+(2.002)+(3.030), (I-746)+(2.002)+(3.031), (I-746)+(2.002)+(5.001), (I-746)+(2.002)+(5.002), (I-746)+(2.002)+(5.003), (I-746)+(2.002)+(5.004), (I-746)+(2.002)+(5.005), (I-746)+(2.002)+(5.006), (I-746)+(2.002)+(5.007), (I-746)+(2.002)+(5.008), (I-746)+(2.002)+(5.009), (I-746)+(2.002)+(5.010), (I-746)+(2.002)+(5.011), (I-746)+(2.002)+(5.012), (I-746)+(2.002)+(5.013), (I-746)+(2.002)+(5.014), (I-746)+(2.002)+(5.015), (I-746)+(2.002)+(5.016), (I-746)+(2.002)+(5.017), (I-746)+(2.002)+(5.018), (I-746)+(2.002)+(5.019), (I-746)+(2.002)+(5.020), (I-746)+(2.002)+(5.021), (I-746)+(2.002)+(5.022), (I-746)+(2.002)+(5.023), (I-746)+(2.002)+(6.001), (I-746)+(2.002)+(6.002), (I-746)+(2.002)+(6.003), (I-746)+(2.002)+(6.004), (I-746)+(2.002)+(7.001), (I-746)+(2.002)+(7.002), (I-746)+(2.002)+(7.003), (I-746)+(2.002)+(7.004), (I-746)+(2.002)+(7.005), (I-746)+(2.002)+(7.006), (I-746)+(2.002)+(9.001), (I-746)+(2.002)+(9.002), (I-746)+(2.002)+(9.003), (I-746)+(2.002)+(9.004), (I-746)+(2.002)+(9.005), (I-746)+(2.002)+(9.006), (I-746)+(2.002)+(9.007), (I-746)+(2.002)+(9.008), (I-746)+(2.002)+(9.009), (I-746)+(2.002)+(14.001), (I-746)+(2.002)+(14.002), (I-746)+(2.002)+(15.008), (I-746)+(2.002)+(15.011), (I-746)+(2.002)+(15.012), (I-746)+(2.002)+(15.016), (I-746)+(2.002)+(15.025), (I-746)+(2.002)+(15.027), (I-746)+(2.002)+(15.047), (I-746)+(2.002)+(15.063), (I-746)+(2.002)+(15.064), (I-746)+(2.002)+(16.001), (I-746)+(2.002)+(16.002), (I-746)+(2.002)+(16.003), (I-746)+(2.002)+(16.004), (I-746)+(2.002)+(16.005), (I-746)+(2.002)+(16.006), (I-746)+(2.002)+(16.007), (I-746)+(2.002)+(16.008), (I-746)+(2.002)+(17.001), (I-746)+(2.002)+(17.002), (I-746)+(2.002)+(17.003), (I-746)+(2.002)+(17.004), (I-746)+(2.002)+(17.005), (I-746)+(2.002)+(17.006), (I-746)+(2.002)+(17.007), (I-746)+(2.002)+(17.008), (I-746)+(2.002)+(17.009), (I-746)+(2.002)+(17.010), (I-746)+(2.002)+(17.011), (I-746)+(2.002)+(17.012), (I-746)+(2.002)+(18.001),

(I-746)+(2.003)+(3.001), (I-746)+(2.003)+(3.002), (I-746)+(2.003)+(3.003), (I-746)+(2.003)+(3.004), (I-746)+(2.003)+(3.005), (I-746)+(2.003)+(3.006), (I-746)+(2.003)+(3.007), (I-746)+(2.003)+(3.008), (I-746)+(2.003)+(3.009), (I-746)+(2.003)+(3.010), (I-746)+(2.003)+(3.011), (I-746)+(2.003)+(3.012), (I-746)+(2.003)+(3.013), (I-746)+(2.003)+(3.014), (I-746)+(2.003)+(3.015), (I-746)+(2.003)+(3.016), (I-746)+(2.003)+(3.017), (I-746)+(2.003)+(3.018), (I-746)+(2.003)+(3.019), (I-746)+(2.003)+(3.020), (I-746)+(2.003)+(3.021), (I-746)+(2.003)+(3.022), (I-746)+(2.003)+(3.023), (I-746)+(2.003)+(3.024), (I-746)+(2.003)+(3.025), (I-746)+(2.003)+(3.026), (I-746)+(2.003)+(3.027), (I-746)+(2.003)+(3.028), (I-746)+(2.003)+(3.029), (I-746)+(2.003)+(3.030), (I-746)+(2.003)+(3.031), (I-746)+(2.003)+(5.001), (I-746)+(2.003)+(5.002), (I-746)+(2.003)+(5.003), (I-746)+(2.003)+(5.004), (I-746)+(2.003)+(5.005), (I-746)+(2.003)+(5.006), (I-746)+(2.003)+(5.007), (I-746)+(2.003)+(5.008), (I-746)+(2.003)+(5.009), (I-746)+(2.003)+(5.010), (I-746)+(2.003)+(5.011), (I-746)+(2.003)+(5.012), (I-746)+(2.003)+(5.013), (I-746)+(2.003)+(5.014), (I-746)+(2.003)+(5.015), (I-746)+(2.003)+(5.016), (I-746)+(2.003)+(5.017), (I-746)+(2.003)+(5.018), (I-746)+(2.003)+(5.019), (I-746)+(2.003)+(5.020), (I-746)+(2.003)+(5.021), (I-746)+(2.003)+(5.022), (I-746)+(2.003)+(5.023), (I-746)+(2.003)+(6.001), (I-746)+(2.003)+(6.002), (I-746)+(2.003)+(6.003), (I-746)+(2.003)+(6.004), (I-746)+(2.003)+(7.001), (I-746)+(2.003)+(7.002), (I-746)+(2.003)+(7.003), (I-746)+(2.003)+(7.004), (I-746)+(2.003)+(7.005), (I-746)+(2.003)+(7.006), (I-746)+(2.003)+(9.001), (I-746)+(2.003)+(9.002), (I-746)+(2.003)+(9.003), (I-746)+(2.003)+(9.004), (I-746)+(2.003)+(9.005), (I-746)+(2.003)+(9.006), (I-746)+(2.003)+(9.007), (I-746)+(2.003)+(9.008), (I-746)+(2.003)+(9.009), (I-746)+(2.003)+(14.001), (I-746)+(2.003)+(14.002), (I-746)+(2.003)+(15.008), (I-746)+(2.003)+(15.011), (I-746)+(2.003)+(15.012), (I-746)+(2.003)+(15.016), (I-746)+(2.003)+(15.025), (I-746)+(2.003)+(15.027), (I-746)+(2.003)+(15.047), (I-746)+(2.003)+(15.063), (I-746)+(2.003)+(15.064), (I-746)+(2.003)+(16.001), (I-746)+(2.003)+(16.002), (I-746)+(2.003)+(16.003), (I-746)+(2.003)+(16.004), (I-746)+(2.003)+(16.005), (I-746)+(2.003)+(16.006), (I-746)+(2.003)+(16.007), (I-746)+(2.003)+(16.008), (I-746)+(2.003)+(17.001), (I-746)+(2.003)+(17.002), (I-746)+(2.003)+(17.003), (I-746)+(2.003)+(17.004), (I-746)+(2.003)+(17.005), (I-746)+(2.003)+(17.006), (I-746)+(2.003)+(17.007), (I-746)+(2.003)+(17.008), (I-746)+(2.003)+(17.009), (I-746)+(2.003)+(17.010), (I-746)+(2.003)+(17.011), (I-746)+(2.003)+(17.012), (I-746)+(2.003)+(18.001),

(I-746)+(2.004)+(3.001), (I-746)+(2.004)+(3.002), (I-746)+(2.004)+(3.003), (I-746)+(2.004)+(3.004), (I-746)+(2.004)+(3.005), (I-746)+(2.004)+(3.006), (I-746)+(2.004)+(3.007), (I-746)+(2.004)+(3.008), (I-746)+(2.004)+(3.009), (I-746)+(2.004)+(3.010), (I-746)+(2.004)+(3.011), (I-746)+(2.004)+(3.012), (I-746)+(2.004)+(3.013), (I-746)+(2.004)+(3.014), (I-746)+(2.004)+(3.015), (I-746)+(2.004)+(3.016), (I-746)+(2.004)+(3.017), (I-746)+(2.004)+(3.018), (I-746)+(2.004)+(3.019), (I-746)+(2.004)+(3.020), (I-746)+(2.004)+(3.021), (I-746)+(2.004)+(3.022), (I-746)+(2.004)+(3.023), (I-746)+(2.004)+(3.024), (I-746)+(2.004)+(3.025), (I-746)+(2.004)+(3.026), (I-746)+(2.004)+(3.027), (I-746)+(2.004)+(3.028), (I-746)+(2.004)+(3.029), (I-746)+(2.004)+(3.030), (I-746)+(2.004)+(3.031), (I-746)+(2.004)+(5.001), (I-746)+(2.004)+(5.002), (I-746)+(2.004)+(5.003), (I-746)+(2.004)+(5.004), (I-746)+(2.004)+(5.005), (I-746)+(2.004)+(5.006), (I-746)+(2.004)+(5.007), (I-746)+(2.004)+(5.008), (I-746)+(2.004)+(5.009), (I-746)+(2.004)+(5.010), (I-746)+(2.004)+(5.011), (I-746)+(2.004)+(5.012), (I-746)+(2.004)+(5.013), (I-746)+(2.004)+(5.014), (I-746)+(2.004)+(5.015), (I-746)+(2.004)+(5.016), (I-746)+(2.004)+(5.017), (I-746)+(2.004)+(5.018), (I-746)+(2.004)+(5.019), (I-746)+(2.004)+(5.020), (I-746)+(2.004)+(5.021), (I-746)+(2.004)+(5.022), (I-746)+(2.004)+(5.023), (I-746)+(2.004)+(6.001), (I-746)+(2.004)+(6.002), (I-746)+(2.004)+(6.003), (I-746)+(2.004)+(6.004), (I-746)+(2.004)+(7.001), (I-746)+(2.004)+(7.002), (I-746)+(2.004)+(7.003), (I-746)+(2.004)+(7.004), (I-746)+(2.004)+(7.005), (I-746)+(2.004)+(7.006), (I-746)+(2.004)+(9.001), (I-746)+(2.004)+(9.002), (I-746)+(2.004)+(9.003), (I-746)+(2.004)+(9.004), (I-746)+(2.004)+(9.005), (I-746)+(2.004)+(9.006), (I-746)+(2.004)+(9.007), (I-746)+(2.004)+(9.008), (I-746)+(2.004)+(9.009), (I-746)+(2.004)+(14.001), (I-746)+(2.004)+(14.002), (I-746)+(2.004)+(15.008), (I-746)+(2.004)+(15.011), (I-746)+(2.004)+(15.012), (I-746)+(2.004)+(15.016), (I-746)+(2.004)+(15.025), (I-746)+(2.004)+(15.027), (I-746)+(2.004)+(15.047), (I-746)+(2.004)+(15.063), (I-746)+(2.004)+(15.064), (I-746)+(2.004)+(16.001), (I-746)+(2.004)+(16.002), (I-746)+(2.004)+(16.003), (I-746)+(2.004)+(16.004), (I-746)+(2.004)+(16.005), (I-746)+(2.004)+(16.006), (I-746)+(2.004)+(16.007), (I-746)+(2.004)+(16.008), (I-746)+(2.004)+(17.001), (I-746)+(2.004)+(17.002), (I-746)+(2.004)+(17.003), (I-746)+(2.004)+(17.004), (I-746)+(2.004)+(17.005), (I-746)+(2.004)+(17.006), (I-746)+(2.004)+(17.007), (I-746)+(2.004)+(17.008), (I-746)+(2.004)+(17.009), (I-746)+(2.004)+(17.010), (I-746)+(2.004)+(17.011), (I-746)+(2.004)+(17.012), (I-746)+(2.004)+(18.001),

(I-746)+(2.005)+(3.001), (I-746)+(2.005)+(3.002), (I-746)+(2.005)+(3.003), (I-746)+(2.005)+(3.004), (I-746)+(2.005)+(3.005), (I-746)+(2.005)+(3.006), (I-746)+(2.005)+(3.007), (I-746)+(2.005)+(3.008), (I-746)+(2.005)+(3.009), (I-746)+(2.005)+(3.010), (I-746)+(2.005)+(3.011), (I-746)+(2.005)+(3.012), (I-746)+(2.005)+(3.013), (I-746)+(2.005)+(3.014), (I-746)+(2.005)+(3.015), (I-746)+(2.005)+(3.016), (I-746)+(2.005)+(3.017), (I-746)+(2.005)+(3.018), (I-746)+(2.005)+(3.019), (I-746)+(2.005)+(3.020), (I-746)+(2.005)+(3.021), (I-746)+(2.005)+(3.022), (I-746)+(2.005)+(3.023), (I-746)+(2.005)+(3.024), (I-746)+(2.005)+(3.025), (I-746)+(2.005)+(3.026), (I-746)+(2.005)+(3.027), (I-746)+(2.005)+(3.028), (I-746)+(2.005)+(3.029), (I-746)+(2.005)+(3.030), (I-746)+(2.005)+(3.031), (I-746)+(2.005)+(5.001), (I-746)+(2.005)+(5.002), (I-746)+(2.005)+(5.003), (I-746)+(2.005)+(5.004), (I-746)+(2.005)+(5.005), (I-746)+(2.005)+(5.006), (I-746)+(2.005)+(5.007), (I-746)+(2.005)+(5.008), (I-746)+(2.005)+(5.009), (I-746)+(2.005)+(5.010), (I-746)+(2.005)+(5.011), (I-746)+(2.005)+(5.012), (I-746)+(2.005)+(5.013), (I-746)+(2.005)+(5.014), (I-746)+(2.005)+(5.015), (I-746)+(2.005)+(5.016), (I-746)+(2.005)+(5.017), (I-746)+(2.005)+(5.018), (I-746)+(2.005)+(5.019), (I-746)+(2.005)+(5.020), (I-746)+(2.005)+(5.021), (I-746)+(2.005)+(5.022), (I-746)+(2.005)+(5.023), (I-746)+(2.005)+(6.001), (I-746)+(2.005)+(6.002), (I-746)+(2.005)+(6.003), (I-746)+(2.005)+(6.004), (I-746)+(2.005)+(7.001), (I-746)+(2.005)+(7.002), (I-746)+(2.005)+(7.003), (I-746)+(2.005)+(7.004), (I-746)+(2.005)+(7.005), (I-746)+(2.005)+(7.006), (I-746)+(2.005)+(9.001), (I-746)+(2.005)+(9.002), (I-746)+(2.005)+(9.003), (I-746)+(2.005)+(9.004), (I-746)+(2.005)+(9.005), (I-746)+(2.005)+(9.006), (I-746)+(2.005)+(9.007), (I-746)+(2.005)+(9.008), (I-746)+(2.005)+(9.009), (I-746)+(2.005)+(14.001), (I-746)+(2.005)+(14.002), (I-746)+(2.005)+(15.008), (I-746)+(2.005)+(15.011), (I-746)+(2.005)+(15.012), (I-746)+(2.005)+(15.016), (I-746)+(2.005)+(15.025), (I-746)+(2.005)+(15.027), (I-746)+(2.005)+(15.047), (I-746)+(2.005)+(15.063), (I-746)+(2.005)+(15.064), (I-746)+(2.005)+(16.001), (I-746)+(2.005)+(16.002), (I-746)+(2.005)+(16.003), (I-746)+(2.005)+(16.004), (I-746)+(2.005)+(16.005), (I-746)+(2.005)+(16.006), (I-746)+(2.005)+(16.007), (I-746)+(2.005)+(16.008), (I-746)+(2.005)+(17.001), (I-746)+(2.005)+(17.002), (I-746)+(2.005)+(17.003), (I-746)+(2.005)+(17.004), (I-746)+(2.005)+(17.005), (I-746)+(2.005)+(17.006), (I-746)+(2.005)+(17.007), (I-746)+(2.005)+(17.008), (I-746)+(2.005)+(17.009), (I-746)+(2.005)+(17.010), (I-746)+(2.005)+(17.011), (I-746)+(2.005)+(17.012), (I-746)+(2.005)+(18.001),

(I-746)+(2.006)+(3.001), (I-746)+(2.006)+(3.002), (I-746)+(2.006)+(3.003), (I-746)+(2.006)+(3.004), (I-746)+(2.006)+(3.005), (I-746)+(2.006)+(3.006), (I-746)+(2.006)+(3.007), (I-746)+(2.006)+(3.008), (I-746)+(2.006)+(3.009), (I-746)+(2.006)+(3.010), (I-746)+(2.006)+(3.011), (I-746)+(2.006)+(3.012), (I-746)+(2.006)+(3.013), (I-746)+(2.006)+(3.014), (I-746)+(2.006)+(3.015), (I-746)+(2.006)+(3.016), (I-746)+(2.006)+(3.017), (I-746)+(2.006)+(3.018), (I-746)+(2.006)+(3.019), (I-746)+(2.006)+(3.020), (I-746)+(2.006)+(3.021), (I-746)+(2.006)+(3.022), (I-746)+(2.006)+(3.023), (I-746)+(2.006)+(3.024), (I-746)+(2.006)+(3.025), (I-746)+(2.006)+(3.026), (I-746)+(2.006)+(3.027), (I-746)+(2.006)+(3.028), (I-746)+(2.006)+(3.029), (I-746)+(2.006)+(3.030), (I-746)+(2.006)+(3.031), (I-746)+(2.006)+(5.001), (I-746)+(2.006)+(5.002), (I-746)+(2.006)+(5.003), (I-746)+(2.006)+(5.004), (I-746)+(2.006)+(5.005), (I-746)+(2.006)+(5.006), (I-746)+(2.006)+(5.007), (I-746)+(2.006)+(5.008), (I-746)+(2.006)+(5.009), (I-746)+(2.006)+(5.010), (I-746)+(2.006)+(5.011), (I-746)+(2.006)+(5.012), (I-746)+(2.006)+(5.013), (I-746)+(2.006)+(5.014), (I-746)+(2.006)+(5.015), (I-746)+(2.006)+(5.016), (I-746)+(2.006)+(5.017), (I-746)+(2.006)+(5.018), (I-746)+(2.006)+(5.019), (I-746)+(2.006)+(5.020), (I-746)+(2.006)+(5.021), (I-746)+(2.006)+(5.022), (I-746)+(2.006)+(5.023), (I-746)+(2.006)+(6.001), (I-746)+(2.006)+(6.002), (I-746)+(2.006)+(6.003), (I-746)+(2.006)+(6.004), (I-746)+(2.006)+(7.001), (I-746)+(2.006)+(7.002), (I-746)+(2.006)+(7.003), (I-746)+(2.006)+(7.004), (I-746)+(2.006)+(7.005), (I-746)+(2.006)+(7.006), (I-746)+(2.006)+(9.001), (I-746)+(2.006)+(9.002), (I-746)+(2.006)+(9.003), (I-746)+(2.006)+(9.004), (I-746)+(2.006)+(9.005), (I-746)+(2.006)+(9.006), (I-746)+(2.006)+(9.007), (I-746)+(2.006)+(9.008), (I-746)+(2.006)+(9.009), (I-746)+(2.006)+(14.001), (I-746)+(2.006)+(14.002), (I-746)+(2.006)+(15.008), (I-746)+(2.006)+(15.011), (I-746)+(2.006)+(15.012), (I-746)+(2.006)+(15.016), (I-746)+(2.006)+(15.025), (I-746)+(2.006)+(15.027), (I-746)+(2.006)+(15.047), (I-746)+(2.006)+(15.063), (I-746)+(2.006)+(15.064), (I-746)+(2.006)+(16.001), (I-746)+(2.006)+(16.002), (I-746)+(2.006)+(16.003), (I-746)+(2.006)+(16.004), (I-746)+(2.006)+(16.005), (I-746)+(2.006)+(16.006), (I-746)+(2.006)+(16.007), (I-746)+(2.006)+(16.008), (I-746)+(2.006)+(17.001), (I-746)+(2.006)+(17.002), (I-746)+(2.006)+(17.003), (I-746)+(2.006)+(17.004), (I-746)+(2.006)+(17.005), (I-746)+(2.006)+(17.006), (I-746)+(2.006)+(17.007), (I-746)+(2.006)+(17.008), (I-746)+(2.006)+(17.009), (I-746)+(2.006)+(17.010), (I-746)+(2.006)+(17.011), (I-746)+(2.006)+(17.012), (I-746)+(2.006)+(18.001),

(I-746)+(2.007)+(3.001), (I-746)+(2.007)+(3.002), (I-746)+(2.007)+(3.003), (I-746)+(2.007)+(3.004), (I-746)+(2.007)+(3.005), (I-746)+(2.007)+(3.006), (I-746)+(2.007)+(3.007), (I-746)+(2.007)+(3.008), (I-746)+(2.007)+(3.009), (I-746)+(2.007)+(3.010), (I-746)+(2.007)+(3.011), (I-746)+(2.007)+(3.012), (I-746)+(2.007)+(3.013), (I-746)+(2.007)+(3.014), (I-746)+(2.007)+(3.015), (I-746)+(2.007)+(3.016), (I-746)+(2.007)+(3.017), (I-746)+(2.007)+(3.018), (I-746)+(2.007)+(3.019), (I-746)+(2.007)+(3.020), (I-746)+(2.007)+(3.021), (I-746)+(2.007)+(3.022), (I-746)+(2.007)+(3.023), (I-746)+(2.007)+(3.024), (I-746)+(2.007)+(3.025), (I-746)+(2.007)+(3.026), (I-746)+(2.007)+(3.027), (I-746)+(2.007)+(3.028), (I-746)+(2.007)+(3.029), (I-746)+(2.007)+(3.030), (I-746)+(2.007)+(3.031), (I-746)+(2.007)+(5.001), (I-746)+(2.007)+(5.002), (I-746)+(2.007)+(5.003), (I-746)+(2.007)+(5.004), (I-746)+(2.007)+(5.005), (I-746)+(2.007)+(5.006), (I-746)+(2.007)+(5.007), (I-746)+(2.007)+(5.008), (I-746)+(2.007)+(5.009), (I-746)+(2.007)+(5.010), (I-746)+(2.007)+(5.011), (I-746)+(2.007)+(5.012), (I-746)+(2.007)+(5.013), (I-746)+(2.007)+(5.014), (I-746)+(2.007)+(5.015), (I-746)+(2.007)+(5.016), (I-746)+(2.007)+(5.017), (I-746)+(2.007)+(5.018), (I-746)+(2.007)+(5.019), (I-746)+(2.007)+(5.020), (I-746)+(2.007)+(5.021), (I-746)+(2.007)+(5.022), (I-746)+(2.007)+(5.023), (I-746)+(2.007)+(6.001), (I-746)+(2.007)+(6.002), (I-746)+(2.007)+(6.003), (I-746)+(2.007)+(6.004), (I-746)+(2.007)+(7.001), (I-746)+(2.007)+(7.002), (I-746)+(2.007)+(7.003), (I-746)+(2.007)+(7.004), (I-746)+(2.007)+(7.005), (I-746)+(2.007)+(7.006), (I-746)+(2.007)+(9.001), (I-746)+(2.007)+(9.002), (I-746)+(2.007)+(9.003), (I-746)+(2.007)+(9.004), (I-746)+(2.007)+(9.005), (I-746)+(2.007)+(9.006), (I-746)+(2.007)+(9.007), (I-746)+(2.007)+(9.008), (I-746)+(2.007)+(9.009), (I-746)+(2.007)+(14.001), (I-746)+(2.007)+(14.002), (I-746)+(2.007)+(15.008), (I-746)+(2.007)+(15.011), (I-746)+(2.007)+(15.012), (I-746)+(2.007)+(15.016), (I-746)+(2.007)+(15.025), (I-746)+(2.007)+(15.027), (I-746)+(2.007)+(15.047), (I-746)+(2.007)+(15.063), (I-746)+(2.007)+(15.064), (I-746)+(2.007)+(16.001), (I-746)+(2.007)+(16.002), (I-746)+(2.007)+(16.003), (I-746)+(2.007)+(16.004), (I-746)+(2.007)+(16.005), (I-746)+(2.007)+(16.006), (I-746)+(2.007)+(16.007), (I-746)+(2.007)+(16.008), (I-746)+(2.007)+(17.001), (I-746)+(2.007)+(17.002), (I-746)+(2.007)+(17.003), (I-746)+(2.007)+(17.004), (I-746)+(2.007)+(17.005), (I-746)+(2.007)+(17.006), (I-746)+(2.007)+(17.007), (I-746)+(2.007)+(17.008), (I-746)+(2.007)+(17.009), (I-746)+(2.007)+(17.010), (I-746)+(2.007)+(17.011), (I-746)+(2.007)+(17.012), (I-746)+(2.007)+(18.001),

(I-746)+(2.008)+(3.001), (I-746)+(2.008)+(3.002), (I-746)+(2.008)+(3.003), (I-746)+(2.008)+(3.004), (I-746)+(2.008)+(3.005), (I-746)+(2.008)+(3.006), (I-746)+(2.008)+(3.007), (I-746)+(2.008)+(3.008), (I-746)+(2.008)+(3.009), (I-746)+(2.008)+(3.010), (I-746)+(2.008)+(3.011), (I-746)+(2.008)+(3.012), (I-746)+(2.008)+(3.013), (I-746)+(2.008)+(3.014), (I-746)+(2.008)+(3.015), (I-746)+(2.008)+(3.016), (I-746)+(2.008)+(3.017), (I-746)+(2.008)+(3.018), (I-746)+(2.008)+(3.019), (I-746)+(2.008)+(3.020), (I-746)+(2.008)+(3.021), (I-746)+(2.008)+(3.022), (I-746)+(2.008)+(3.023), (I-746)+(2.008)+(3.024), (I-746)+(2.008)+(3.025), (I-746)+(2.008)+(3.026), (I-746)+(2.008)+(3.027), (I-746)+(2.008)+(3.028), (I-746)+(2.008)+(3.029), (I-746)+(2.008)+(3.030), (I-746)+(2.008)+(3.031), (I-746)+(2.008)+(5.001), (I-746)+(2.008)+(5.002), (I-746)+(2.008)+(5.003), (I-746)+(2.008)+(5.004), (I-746)+(2.008)+(5.005), (I-746)+(2.008)+(5.006), (I-746)+(2.008)+(5.007), (I-746)+(2.008)+(5.008), (I-746)+(2.008)+(5.009), (I-746)+(2.008)+(5.010), (I-746)+(2.008)+(5.011), (I-746)+(2.008)+(5.012), (I-746)+(2.008)+(5.013), (I-746)+(2.008)+(5.014), (I-746)+(2.008)+(5.015), (I-746)+(2.008)+(5.016), (I-746)+(2.008)+(5.017), (I-746)+(2.008)+(5.018), (I-746)+(2.008)+(5.019), (I-746)+(2.008)+(5.020), (I-746)+(2.008)+(5.021), (I-746)+(2.008)+(5.022), (I-746)+(2.008)+(5.023), (I-746)+(2.008)+(6.001), (I-746)+(2.008)+(6.002), (I-746)+(2.008)+(6.003), (I-746)+(2.008)+(6.004), (I-746)+(2.008)+(7.001), (I-746)+(2.008)+(7.002), (I-746)+(2.008)+(7.003), (I-746)+(2.008)+(7.004), (I-746)+(2.008)+(7.005), (I-746)+(2.008)+(7.006), (I-746)+(2.008)+(9.001), (I-746)+(2.008)+(9.002), (I-746)+(2.008)+(9.003), (I-746)+(2.008)+(9.004), (I-746)+(2.008)+(9.005), (I-746)+(2.008)+(9.006), (I-746)+(2.008)+(9.007), (I-746)+(2.008)+(9.008), (I-746)+(2.008)+(9.009), (I-746)+(2.008)+(14.001), (I-746)+(2.008)+(14.002), (I-746)+(2.008)+(15.008), (I-746)+(2.008)+(15.011), (I-746)+(2.008)+(15.012), (I-746)+(2.008)+(15.016), (I-746)+(2.008)+(15.025), (I-746)+(2.008)+(15.027), (I-746)+(2.008)+(15.047), (I-746)+(2.008)+(15.063), (I-746)+(2.008)+(15.064), (I-746)+(2.008)+(16.001), (I-746)+(2.008)+(16.002), (I-746)+(2.008)+(16.003), (I-746)+(2.008)+(16.004), (I-746)+(2.008)+(16.005), (I-746)+(2.008)+(16.006), (I-746)+(2.008)+(16.007), (I-746)+(2.008)+(16.008), (I-746)+(2.008)+(17.001), (I-746)+(2.008)+(17.002), (I-746)+(2.008)+(17.003), (I-746)+(2.008)+(17.004), (I-746)+(2.008)+(17.005), (I-746)+(2.008)+(17.006), (I-746)+(2.008)+(17.007), (I-746)+(2.008)+(17.008), (I-746)+(2.008)+(17.009), (I-746)+(2.008)+(17.010), (I-746)+(2.008)+(17.011), (I-746)+(2.008)+(17.012), (I-746)+(2.008)+(18.001),

(I-746)+(2.009)+(3.001), (I-746)+(2.009)+(3.002), (I-746)+(2.009)+(3.003), (I-746)+(2.009)+(3.004), (I-746)+(2.009)+(3.005), (I-746)+(2.009)+(3.006), (I-746)+(2.009)+(3.007), (I-746)+(2.009)+(3.008), (I-746)+(2.009)+(3.009), (I-746)+(2.009)+(3.010), (I-746)+(2.009)+(3.011), (I-746)+(2.009)+(3.012), (I-746)+(2.009)+(3.013), (I-746)+(2.009)+(3.014), (I-746)+(2.009)+(3.015), (I-746)+(2.009)+(3.016), (I-746)+(2.009)+(3.017), (I-746)+(2.009)+(3.018), (I-746)+(2.009)+(3.019), (I-746)+(2.009)+(3.020), (I-746)+(2.009)+(3.021), (I-746)+(2.009)+(3.022), (I-746)+(2.009)+(3.023), (I-746)+(2.009)+(3.024), (I-746)+(2.009)+(3.025), (I-746)+(2.009)+(3.026), (I-746)+(2.009)+(3.027), (I-746)+(2.009)+(3.028), (I-746)+(2.009)+(3.029), (I-746)+(2.009)+(3.030), (I-746)+(2.009)+(3.031), (I-746)+(2.009)+(5.001), (I-746)+(2.009)+(5.002), (I-746)+(2.009)+(5.003), (I-746)+(2.009)+(5.004), (I-746)+(2.009)+(5.005), (I-746)+(2.009)+(5.006), (I-746)+(2.009)+(5.007), (I-746)+(2.009)+(5.008), (I-746)+(2.009)+(5.009), (I-746)+(2.009)+(5.010), (I-746)+(2.009)+(5.011), (I-746)+(2.009)+(5.012), (I-746)+(2.009)+(5.013), (I-746)+(2.009)+(5.014), (I-746)+(2.009)+(5.015), (I-746)+(2.009)+(5.016), (I-746)+(2.009)+(5.017), (I-746)+(2.009)+(5.018), (I-746)+(2.009)+(5.019), (I-746)+(2.009)+(5.020), (I-746)+(2.009)+(5.021), (I-746)+(2.009)+(5.022), (I-746)+(2.009)+(5.023), (I-746)+(2.009)+(6.001), (I-746)+(2.009)+(6.002), (I-746)+(2.009)+(6.003), (I-746)+(2.009)+(6.004), (I-746)+(2.009)+(7.001), (I-746)+(2.009)+(7.002), (I-746)+(2.009)+(7.003), (I-746)+(2.009)+(7.004), (I-746)+(2.009)+(7.005), (I-746)+(2.009)+(7.006), (I-746)+(2.009)+(9.001), (I-746)+(2.009)+(9.002), (I-746)+(2.009)+(9.003), (I-746)+(2.009)+(9.004), (I-746)+(2.009)+(9.005), (I-746)+(2.009)+(9.006), (I-746)+(2.009)+(9.007), (I-746)+(2.009)+(9.008), (I-746)+(2.009)+(9.009), (I-746)+(2.009)+(14.001), (I-746)+(2.009)+(14.002), (I-746)+(2.009)+(15.008), (I-746)+(2.009)+(15.011), (I-746)+(2.009)+(15.012), (I-746)+(2.009)+(15.016), (I-746)+(2.009)+(15.025), (I-746)+(2.009)+(15.027), (I-746)+(2.009)+(15.047), (I-746)+(2.009)+(15.063), (I-746)+(2.009)+(15.064), (I-746)+(2.009)+(16.001), (I-746)+(2.009)+(16.002), (I-746)+(2.009)+(16.003), (I-746)+(2.009)+(16.004), (I-746)+(2.009)+(16.005), (I-746)+(2.009)+(16.006), (I-746)+(2.009)+(16.007), (I-746)+(2.009)+(16.008), (I-746)+(2.009)+(17.001), (I-746)+(2.009)+(17.002), (I-746)+(2.009)+(17.003), (I-746)+(2.009)+(17.004), (I-746)+(2.009)+(17.005), (I-746)+(2.009)+(17.006), (I-746)+(2.009)+(17.007), (I-746)+(2.009)+(17.008), (I-746)+(2.009)+(17.009), (I-746)+(2.009)+(17.010), (I-746)+(2.009)+(17.011), (I-746)+(2.009)+(17.012), (I-746)+(2.009)+(18.001),

(I-746)+(2.010)+(3.001), (I-746)+(2.010)+(3.002), (I-746)+(2.010)+(3.003), (I-746)+(2.010)+(3.004), (I-746)+(2.010)+(3.005), (I-746)+(2.010)+(3.006), (I-746)+(2.010)+(3.007), (I-746)+(2.010)+(3.008), (I-746)+(2.010)+(3.009), (I-746)+(2.010)+(3.010), (I-746)+(2.010)+(3.011), (I-746)+(2.010)+(3.012), (I-746)+(2.010)+(3.013), (I-746)+(2.010)+(3.014), (I-746)+(2.010)+(3.015), (I-746)+(2.010)+(3.016), (I-746)+(2.010)+(3.017), (I-746)+(2.010)+(3.018), (I-746)+(2.010)+(3.019), (I-746)+(2.010)+(3.020), (I-746)+(2.010)+(3.021), (I-746)+(2.010)+(3.022), (I-746)+(2.010)+(3.023), (I-746)+(2.010)+(3.024), (I-746)+(2.010)+(3.025), (I-746)+(2.010)+(3.026), (I-746)+(2.010)+(3.027), (I-746)+(2.010)+(3.028), (I-746)+(2.010)+(3.029), (I-746)+(2.010)+(3.030), (I-746)+(2.010)+(3.031), (I-746)+(2.010)+(5.001), (I-746)+(2.010)+(5.002), (I-746)+(2.010)+(5.003), (I-746)+(2.010)+(5.004), (I-746)+(2.010)+(5.005), (I-746)+(2.010)+(5.006), (I-746)+(2.010)+(5.007), (I-746)+(2.010)+(5.008), (I-746)+(2.010)+(5.009), (I-746)+(2.010)+(5.010), (I-746)+(2.010)+(5.011), (I-746)+(2.010)+(5.012), (I-746)+(2.010)+(5.013), (I-746)+(2.010)+(5.014), (I-746)+(2.010)+(5.015), (I-746)+(2.010)+(5.016), (I-746)+(2.010)+(5.017), (I-746)+(2.010)+(5.018), (I-746)+(2.010)+(5.019), (I-746)+(2.010)+(5.020), (I-746)+(2.010)+(5.021), (I-746)+(2.010)+(5.022), (I-746)+(2.010)+(5.023), (I-746)+(2.010)+(6.001), (I-746)+(2.010)+(6.002), (I-746)+(2.010)+(6.003), (I-746)+(2.010)+(6.004), (I-746)+(2.010)+(7.001), (I-746)+(2.010)+(7.002), (I-746)+(2.010)+(7.003), (I-746)+(2.010)+(7.004), (I-746)+(2.010)+(7.005), (I-746)+(2.010)+(7.006), (I-746)+(2.010)+(9.001), (I-746)+(2.010)+(9.002), (I-746)+(2.010)+(9.003), (I-746)+(2.010)+(9.004), (I-746)+(2.010)+(9.005), (I-746)+(2.010)+(9.006), (I-746)+(2.010)+(9.007), (I-746)+(2.010)+(9.008), (I-746)+(2.010)+(9.009), (I-746)+(2.010)+(14.001), (I-746)+(2.010)+(14.002), (I-746)+(2.010)+(15.008), (I-746)+(2.010)+(15.011), (I-746)+(2.010)+(15.012), (I-746)+(2.010)+(15.016), (I-746)+(2.010)+(15.025), (I-746)+(2.010)+(15.027), (I-746)+(2.010)+(15.047), (I-746)+(2.010)+(15.063), (I-746)+(2.010)+(15.064), (I-746)+(2.010)+(16.001), (I-746)+(2.010)+(16.002), (I-746)+(2.010)+(16.003), (I-746)+(2.010)+(16.004), (I-746)+(2.010)+(16.005), (I-746)+(2.010)+(16.006), (I-746)+(2.010)+(16.007), (I-746)+(2.010)+(16.008), (I-746)+(2.010)+(17.001), (I-746)+(2.010)+(17.002), (I-746)+(2.010)+(17.003), (I-746)+(2.010)+(17.004), (I-746)+(2.010)+(17.005), (I-746)+(2.010)+(17.006), (I-746)+(2.010)+(17.007), (I-746)+(2.010)+(17.008), (I-746)+(2.010)+(17.009), (I-746)+(2.010)+(17.010), (I-746)+(2.010)+(17.011), (I-746)+(2.010)+(17.012), (I-746)+(2.010)+(18.001),

(I-746)+(2.011)+(3.001), (I-746)+(2.011)+(3.002), (I-746)+(2.011)+(3.003), (I-746)+(2.011)+(3.004), (I-746)+(2.011)+(3.005), (I-746)+(2.011)+(3.006), (I-746)+(2.011)+(3.007), (I-746)+(2.011)+(3.008), (I-746)+(2.011)+(3.009), (I-746)+(2.011)+(3.010), (I-746)+(2.011)+(3.011), (I-746)+(2.011)+(3.012), (I-746)+(2.011)+(3.013), (I-746)+(2.011)+(3.014), (I-746)+(2.011)+(3.015), (I-746)+(2.011)+(3.016), (I-746)+(2.011)+(3.017), (I-746)+(2.011)+(3.018), (I-746)+(2.011)+(3.019), (I-746)+(2.011)+(3.020), (I-746)+(2.011)+(3.021), (I-746)+(2.011)+(3.022), (I-746)+(2.011)+(3.023), (I-746)+(2.011)+(3.024), (I-746)+(2.011)+(3.025), (I-746)+(2.011)+(3.026), (I-746)+(2.011)+(3.027), (I-746)+(2.011)+(3.028), (I-746)+(2.011)+(3.029), (I-746)+(2.011)+(3.030), (I-746)+(2.011)+(3.031), (I-746)+(2.011)+(5.001), (I-746)+(2.011)+(5.002), (I-746)+(2.011)+(5.003), (I-746)+(2.011)+(5.004), (I-746)+(2.011)+(5.005), (I-746)+(2.011)+(5.006), (I-746)+(2.011)+(5.007), (I-746)+(2.011)+(5.008), (I-746)+(2.011)+(5.009), (I-746)+(2.011)+(5.010), (I-746)+(2.011)+(5.011), (I-746)+(2.011)+(5.012), (I-746)+(2.011)+(5.013), (I-746)+(2.011)+(5.014), (I-746)+(2.011)+(5.015), (I-746)+(2.011)+(5.016), (I-746)+(2.011)+(5.017), (I-746)+(2.011)+(5.018), (I-746)+(2.011)+(5.019), (I-746)+(2.011)+(5.020), (I-746)+(2.011)+(5.021), (I-746)+(2.011)+(5.022), (I-746)+(2.011)+(5.023), (I-746)+(2.011)+(6.001), (I-746)+(2.011)+(6.002), (I-746)+(2.011)+(6.003), (I-746)+(2.011)+(6.004), (I-746)+(2.011)+(7.001), (I-746)+(2.011)+(7.002), (I-746)+(2.011)+(7.003), (I-746)+(2.011)+(7.004), (I-746)+(2.011)+(7.005), (I-746)+(2.011)+(7.006), (I-746)+(2.011)+(9.001), (I-746)+(2.011)+(9.002), (I-746)+(2.011)+(9.003), (I-746)+(2.011)+(9.004), (I-746)+(2.011)+(9.005), (I-746)+(2.011)+(9.006), (I-746)+(2.011)+(9.007), (I-746)+(2.011)+(9.008), (I-746)+(2.011)+(9.009), (I-746)+(2.011)+(14.001), (I-746)+(2.011)+(14.002), (I-746)+(2.011)+(15.008), (I-746)+(2.011)+(15.011), (I-746)+(2.011)+(15.012), (I-746)+(2.011)+(15.016), (I-746)+(2.011)+(15.025), (I-746)+(2.011)+(15.027), (I-746)+(2.011)+(15.047), (I-746)+(2.011)+(15.063), (I-746)+(2.011)+(15.064), (I-746)+(2.011)+(16.001), (I-746)+(2.011)+(16.002), (I-746)+(2.011)+(16.003), (I-746)+(2.011)+(16.004), (I-746)+(2.011)+(16.005), (I-746)+(2.011)+(16.006), (I-746)+(2.011)+(16.007), (I-746)+(2.011)+(16.008), (I-746)+(2.011)+(17.001), (I-746)+(2.011)+(17.002), (I-746)+(2.011)+(17.003), (I-746)+(2.011)+(17.004), (I-746)+(2.011)+(17.005), (I-746)+(2.011)+(17.006), (I-746)+(2.011)+(17.007), (I-746)+(2.011)+(17.008), (I-746)+(2.011)+(17.009), (I-746)+(2.011)+(17.010), (I-746)+(2.011)+(17.011), (I-746)+(2.011)+(17.012), (I-746)+(2.011)+(18.001),

(I-746)+(2.012)+(3.001), (I-746)+(2.012)+(3.002), (I-746)+(2.012)+(3.003), (I-746)+(2.012)+(3.004), (I-746)+(2.012)+(3.005), (I-746)+(2.012)+(3.006), (I-746)+(2.012)+(3.007), (I-746)+(2.012)+(3.008), (I-746)+(2.012)+(3.009), (I-746)+(2.012)+(3.010), (I-746)+(2.012)+(3.011), (I-746)+(2.012)+(3.012), (I-746)+(2.012)+(3.013), (I-746)+(2.012)+(3.014), (I-746)+(2.012)+(3.015), (I-746)+(2.012)+(3.016), (I-746)+(2.012)+(3.017), (I-746)+(2.012)+(3.018), (I-746)+(2.012)+(3.019), (I-746)+(2.012)+(3.020), (I-746)+(2.012)+(3.021), (I-746)+(2.012)+(3.022), (I-746)+(2.012)+(3.023), (I-746)+(2.012)+(3.024), (I-746)+(2.012)+(3.025), (I-746)+(2.012)+(3.026), (I-746)+(2.012)+(3.027), (I-746)+(2.012)+(3.028), (I-746)+(2.012)+(3.029), (I-746)+(2.012)+(3.030), (I-746)+(2.012)+(3.031), (I-746)+(2.012)+(5.001), (I-746)+(2.012)+(5.002), (I-746)+(2.012)+(5.003), (I-746)+(2.012)+(5.004), (I-746)+(2.012)+(5.005), (I-746)+(2.012)+(5.006), (I-746)+(2.012)+(5.007), (I-746)+(2.012)+(5.008), (I-746)+(2.012)+(5.009), (I-746)+(2.012)+(5.010), (I-746)+(2.012)+(5.011), (I-746)+(2.012)+(5.012), (I-746)+(2.012)+(5.013), (I-746)+(2.012)+(5.014), (I-746)+(2.012)+(5.015), (I-746)+(2.012)+(5.016), (I-746)+(2.012)+(5.017), (I-746)+(2.012)+(5.018), (I-746)+(2.012)+(5.019), (I-746)+(2.012)+(5.020), (I-746)+(2.012)+(5.021), (I-746)+(2.012)+(5.022), (I-746)+(2.012)+(5.023), (I-746)+(2.012)+(6.001), (I-746)+(2.012)+(6.002), (I-746)+(2.012)+(6.003), (I-746)+(2.012)+(6.004), (I-746)+(2.012)+(7.001), (I-746)+(2.012)+(7.002), (I-746)+(2.012)+(7.003), (I-746)+(2.012)+(7.004), (I-746)+(2.012)+(7.005), (I-746)+(2.012)+(7.006), (I-746)+(2.012)+(9.001), (I-746)+(2.012)+(9.002), (I-746)+(2.012)+(9.003), (I-746)+(2.012)+(9.004), (I-746)+(2.012)+(9.005), (I-746)+(2.012)+(9.006), (I-746)+(2.012)+(9.007), (I-746)+(2.012)+(9.008), (I-746)+(2.012)+(9.009), (I-746)+(2.012)+(14.001), (I-746)+(2.012)+(14.002), (I-746)+(2.012)+(15.008), (I-746)+(2.012)+(15.011), (I-746)+(2.012)+(15.012), (I-746)+(2.012)+(15.016), (I-746)+(2.012)+(15.025), (I-746)+(2.012)+(15.027), (I-746)+(2.012)+(15.047), (I-746)+(2.012)+(15.063), (I-746)+(2.012)+(15.064), (I-746)+(2.012)+(16.001), (I-746)+(2.012)+(16.002), (I-746)+(2.012)+(16.003), (I-746)+(2.012)+(16.004), (I-746)+(2.012)+(16.005), (I-746)+(2.012)+(16.006), (I-746)+(2.012)+(16.007), (I-746)+(2.012)+(16.008), (I-746)+(2.012)+(17.001), (I-746)+(2.012)+(17.002), (I-746)+(2.012)+(17.003), (I-746)+(2.012)+(17.004), (I-746)+(2.012)+(17.005), (I-746)+(2.012)+(17.006), (I-746)+(2.012)+(17.007), (I-746)+(2.012)+(17.008), (I-746)+(2.012)+(17.009), (I-746)+(2.012)+(17.010), (I-746)+(2.012)+(17.011), (I-746)+(2.012)+(17.012), (I-746)+(2.012)+(18.001),

(I-746)+(2.013)+(3.001), (I-746)+(2.013)+(3.002), (I-746)+(2.013)+(3.003), (I-746)+(2.013)+(3.004), (I-746)+(2.013)+(3.005), (I-746)+(2.013)+(3.006), (I-746)+(2.013)+(3.007), (I-746)+(2.013)+(3.008), (I-746)+(2.013)+(3.009), (I-746)+(2.013)+(3.010), (I-746)+(2.013)+(3.011), (I-746)+(2.013)+(3.012), (I-746)+(2.013)+(3.013), (I-746)+(2.013)+(3.014), (I-746)+(2.013)+(3.015), (I-746)+(2.013)+(3.016), (I-746)+(2.013)+(3.017), (I-746)+(2.013)+(3.018), (I-746)+(2.013)+(3.019), (I-746)+(2.013)+(3.020), (I-746)+(2.013)+(3.021), (I-746)+(2.013)+(3.022), (I-746)+(2.013)+(3.023), (I-746)+(2.013)+(3.024), (I-746)+(2.013)+(3.025), (I-746)+(2.013)+(3.026), (I-746)+(2.013)+(3.027), (I-746)+(2.013)+(3.028), (I-746)+(2.013)+(3.029), (I-746)+(2.013)+(3.030), (I-746)+(2.013)+(3.031), (I-746)+(2.013)+(5.001), (I-746)+(2.013)+(5.002), (I-746)+(2.013)+(5.003), (I-746)+(2.013)+(5.004), (I-746)+(2.013)+(5.005), (I-746)+(2.013)+(5.006), (I-746)+(2.013)+(5.007), (I-746)+(2.013)+(5.008), (I-746)+(2.013)+(5.009), (I-746)+(2.013)+(5.010), (I-746)+(2.013)+(5.011), (I-746)+(2.013)+(5.012), (I-746)+(2.013)+(5.013), (I-746)+(2.013)+(5.014), (I-746)+(2.013)+(5.015), (I-746)+(2.013)+(5.016), (I-746)+(2.013)+(5.017), (I-746)+(2.013)+(5.018), (I-746)+(2.013)+(5.019), (I-746)+(2.013)+(5.020), (I-746)+(2.013)+(5.021), (I-746)+(2.013)+(5.022), (I-746)+(2.013)+(5.023), (I-746)+(2.013)+(6.001), (I-746)+(2.013)+(6.002), (I-746)+(2.013)+(6.003), (I-746)+(2.013)+(6.004), (I-746)+(2.013)+(7.001), (I-746)+(2.013)+(7.002), (I-746)+(2.013)+(7.003), (I-746)+(2.013)+(7.004), (I-746)+(2.013)+(7.005), (I-746)+(2.013)+(7.006), (I-746)+(2.013)+(9.001), (I-746)+(2.013)+(9.002), (I-746)+(2.013)+(9.003), (I-746)+(2.013)+(9.004), (I-746)+(2.013)+(9.005), (I-746)+(2.013)+(9.006), (I-746)+(2.013)+(9.007), (I-746)+(2.013)+(9.008), (I-746)+(2.013)+(9.009), (I-746)+(2.013)+(14.001), (I-746)+(2.013)+(14.002), (I-746)+(2.013)+(15.008), (I-746)+(2.013)+(15.011), (I-746)+(2.013)+(15.012), (I-746)+(2.013)+(15.016), (I-746)+(2.013)+(15.025), (I-746)+(2.013)+(15.027), (I-746)+(2.013)+(15.047), (I-746)+(2.013)+(15.063), (I-746)+(2.013)+(15.064), (I-746)+(2.013)+(16.001), (I-746)+(2.013)+(16.002), (I-746)+(2.013)+(16.003), (I-746)+(2.013)+(16.004), (I-746)+(2.013)+(16.005), (I-746)+(2.013)+(16.006), (I-746)+(2.013)+(16.007), (I-746)+(2.013)+(16.008), (I-746)+(2.013)+(17.001), (I-746)+(2.013)+(17.002), (I-746)+(2.013)+(17.003), (I-746)+(2.013)+(17.004), (I-746)+(2.013)+(17.005), (I-746)+(2.013)+(17.006), (I-746)+(2.013)+(17.007), (I-746)+(2.013)+(17.008), (I-746)+(2.013)+(17.009), (I-746)+(2.013)+(17.010), (I-746)+(2.013)+(17.011), (I-746)+(2.013)+(17.012), (I-746)+(2.013)+(18.001),

(I-746)+(2.014)+(3.001), (I-746)+(2.014)+(3.002), (I-746)+(2.014)+(3.003), (I-746)+(2.014)+(3.004), (I-746)+(2.014)+(3.005), (I-746)+(2.014)+(3.006), (I-746)+(2.014)+(3.007), (I-746)+(2.014)+(3.008), (I-746)+(2.014)+(3.009), (I-746)+(2.014)+(3.010), (I-746)+(2.014)+(3.011), (I-746)+(2.014)+(3.012), (I-746)+(2.014)+(3.013), (I-746)+(2.014)+(3.014), (I-746)+(2.014)+(3.015), (I-746)+(2.014)+(3.016), (I-746)+(2.014)+(3.017), (I-746)+(2.014)+(3.018), (I-746)+(2.014)+(3.019), (I-746)+(2.014)+(3.020), (I-746)+(2.014)+(3.021), (I-746)+(2.014)+(3.022), (I-746)+(2.014)+(3.023), (I-746)+(2.014)+(3.024), (I-746)+(2.014)+(3.025), (I-746)+(2.014)+(3.026), (I-746)+(2.014)+(3.027), (I-746)+(2.014)+(3.028), (I-746)+(2.014)+(3.029), (I-746)+(2.014)+(3.030), (I-746)+(2.014)+(3.031), (I-746)+(2.014)+(5.001), (I-746)+(2.014)+(5.002), (I-746)+(2.014)+(5.003), (I-746)+(2.014)+(5.004), (I-746)+(2.014)+(5.005), (I-746)+(2.014)+(5.006), (I-746)+(2.014)+(5.007), (I-746)+(2.014)+(5.008), (I-746)+(2.014)+(5.009), (I-746)+(2.014)+(5.010), (I-746)+(2.014)+(5.011), (I-746)+(2.014)+(5.012), (I-746)+(2.014)+(5.013), (I-746)+(2.014)+(5.014), (I-746)+(2.014)+(5.015), (I-746)+(2.014)+(5.016), (I-746)+(2.014)+(5.017), (I-746)+(2.014)+(5.018), (I-746)+(2.014)+(5.019), (I-746)+(2.014)+(5.020), (I-746)+(2.014)+(5.021), (I-746)+(2.014)+(5.022), (I-746)+(2.014)+(5.023), (I-746)+(2.014)+(6.001), (I-746)+(2.014)+(6.002), (I-746)+(2.014)+(6.003), (I-746)+(2.014)+(6.004), (I-746)+(2.014)+(7.001), (I-746)+(2.014)+(7.002), (I-746)+(2.014)+(7.003), (I-746)+(2.014)+(7.004), (I-746)+(2.014)+(7.005), (I-746)+(2.014)+(7.006), (I-746)+(2.014)+(9.001), (I-746)+(2.014)+(9.002), (I-746)+(2.014)+(9.003), (I-746)+(2.014)+(9.004), (I-746)+(2.014)+(9.005), (I-746)+(2.014)+(9.006), (I-746)+(2.014)+(9.007), (I-746)+(2.014)+(9.008), (I-746)+(2.014)+(9.009), (I-746)+(2.014)+(14.001), (I-746)+(2.014)+(14.002), (I-746)+(2.014)+(15.008), (I-746)+(2.014)+(15.011), (I-746)+(2.014)+(15.012), (I-746)+(2.014)+(15.016), (I-746)+(2.014)+(15.025), (I-746)+(2.014)+(15.027), (I-746)+(2.014)+(15.047), (I-746)+(2.014)+(15.063), (I-746)+(2.014)+(15.064), (I-746)+(2.014)+(16.001), (I-746)+(2.014)+(16.002), (I-746)+(2.014)+(16.003), (I-746)+(2.014)+(16.004), (I-746)+(2.014)+(16.005), (I-746)+(2.014)+(16.006), (I-746)+(2.014)+(16.007), (I-746)+(2.014)+(16.008), (I-746)+(2.014)+(17.001), (I-746)+(2.014)+(17.002), (I-746)+(2.014)+(17.003), (I-746)+(2.014)+(17.004), (I-746)+(2.014)+(17.005), (I-746)+(2.014)+(17.006), (I-746)+(2.014)+(17.007), (I-746)+(2.014)+(17.008), (I-746)+(2.014)+(17.009), (I-746)+(2.014)+(17.010), (I-746)+(2.014)+(17.011), (I-746)+(2.014)+(17.012), (I-746)+(2.014)+(18.001),

(I-746)+(2.015)+(3.001), (I-746)+(2.015)+(3.002), (I-746)+(2.015)+(3.003), (I-746)+(2.015)+(3.004), (I-746)+(2.015)+(3.005), (I-746)+(2.015)+(3.006), (I-746)+(2.015)+(3.007), (I-746)+(2.015)+(3.008), (I-746)+(2.015)+(3.009), (I-746)+(2.015)+(3.010), (I-746)+(2.015)+(3.011), (I-746)+(2.015)+(3.012), (I-746)+(2.015)+(3.013), (I-746)+(2.015)+(3.014), (I-746)+(2.015)+(3.015), (I-746)+(2.015)+(3.016), (I-746)+(2.015)+(3.017), (I-746)+(2.015)+(3.018), (I-746)+(2.015)+(3.019), (I-746)+(2.015)+(3.020), (I-746)+(2.015)+(3.021), (I-746)+(2.015)+(3.022), (I-746)+(2.015)+(3.023), (I-746)+(2.015)+(3.024), (I-746)+(2.015)+(3.025), (I-746)+(2.015)+(3.026), (I-746)+(2.015)+(3.027), (I-746)+(2.015)+(3.028), (I-746)+(2.015)+(3.029), (I-746)+(2.015)+(3.030), (I-746)+(2.015)+(3.031), (I-746)+(2.015)+(5.001), (I-746)+(2.015)+(5.002), (I-746)+(2.015)+(5.003), (I-746)+(2.015)+(5.004), (I-746)+(2.015)+(5.005), (I-746)+(2.015)+(5.006), (I-746)+(2.015)+(5.007), (I-746)+(2.015)+(5.008), (I-746)+(2.015)+(5.009), (I-746)+(2.015)+(5.010), (I-746)+(2.015)+(5.011), (I-746)+(2.015)+(5.012), (I-746)+(2.015)+(5.013), (I-746)+(2.015)+(5.014), (I-746)+(2.015)+(5.015), (I-746)+(2.015)+(5.016), (I-746)+(2.015)+(5.017), (I-746)+(2.015)+(5.018), (I-746)+(2.015)+(5.019), (I-746)+(2.015)+(5.020), (I-746)+(2.015)+(5.021), (I-746)+(2.015)+(5.022), (I-746)+(2.015)+(5.023), (I-746)+(2.015)+(6.001), (I-746)+(2.015)+(6.002), (I-746)+(2.015)+(6.003), (I-746)+(2.015)+(6.004), (I-746)+(2.015)+(7.001), (I-746)+(2.015)+(7.002), (I-746)+(2.015)+(7.003), (I-746)+(2.015)+(7.004), (I-746)+(2.015)+(7.005), (I-746)+(2.015)+(7.006), (I-746)+(2.015)+(9.001), (I-746)+(2.015)+(9.002), (I-746)+(2.015)+(9.003), (I-746)+(2.015)+(9.004), (I-746)+(2.015)+(9.005), (I-746)+(2.015)+(9.006), (I-746)+(2.015)+(9.007), (I-746)+(2.015)+(9.008), (I-746)+(2.015)+(9.009), (I-746)+(2.015)+(14.001), (I-746)+(2.015)+(14.002), (I-746)+(2.015)+(15.008), (I-746)+(2.015)+(15.011), (I-746)+(2.015)+(15.012), (I-746)+(2.015)+(15.016), (I-746)+(2.015)+(15.025), (I-746)+(2.015)+(15.027), (I-746)+(2.015)+(15.047), (I-746)+(2.015)+(15.063), (I-746)+(2.015)+(15.064), (I-746)+(2.015)+(16.001), (I-746)+(2.015)+(16.002), (I-746)+(2.015)+(16.003), (I-746)+(2.015)+(16.004), (I-746)+(2.015)+(16.005), (I-746)+(2.015)+(16.006), (I-746)+(2.015)+(16.007), (I-746)+(2.015)+(16.008), (I-746)+(2.015)+(17.001), (I-746)+(2.015)+(17.002), (I-746)+(2.015)+(17.003), (I-746)+(2.015)+(17.004), (I-746)+(2.015)+(17.005), (I-746)+(2.015)+(17.006), (I-746)+(2.015)+(17.007), (I-746)+(2.015)+(17.008), (I-746)+(2.015)+(17.009), (I-746)+(2.015)+(17.010), (I-746)+(2.015)+(17.011), (I-746)+(2.015)+(17.012), (I-746)+(2.015)+(18.001),

(I-746)+(2.016)+(3.001), (I-746)+(2.016)+(3.002), (I-746)+(2.016)+(3.003), (I-746)+(2.016)+(3.004), (I-746)+(2.016)+(3.005), (I-746)+(2.016)+(3.006), (I-746)+(2.016)+(3.007), (I-746)+(2.016)+(3.008), (I-746)+(2.016)+(3.009), (I-746)+(2.016)+(3.010), (I-746)+(2.016)+(3.011), (I-746)+(2.016)+(3.012), (I-746)+(2.016)+(3.013), (I-746)+(2.016)+(3.014), (I-746)+(2.016)+(3.015), (I-746)+(2.016)+(3.016), (I-746)+(2.016)+(3.017), (I-746)+(2.016)+(3.018), (I-746)+(2.016)+(3.019), (I-746)+(2.016)+(3.020), (I-746)+(2.016)+(3.021), (I-746)+(2.016)+(3.022), (I-746)+(2.016)+(3.023), (I-746)+(2.016)+(3.024), (I-746)+(2.016)+(3.025), (I-746)+(2.016)+(3.026), (I-746)+(2.016)+(3.027), (I-746)+(2.016)+(3.028), (I-746)+(2.016)+(3.029), (I-746)+(2.016)+(3.030), (I-746)+(2.016)+(3.031), (I-746)+(2.016)+(5.001), (I-746)+(2.016)+(5.002), (I-746)+(2.016)+(5.003), (I-746)+(2.016)+(5.004), (I-746)+(2.016)+(5.005), (I-746)+(2.016)+(5.006), (I-746)+(2.016)+(5.007), (I-746)+(2.016)+(5.008), (I-746)+(2.016)+(5.009), (I-746)+(2.016)+(5.010), (I-746)+(2.016)+(5.011), (I-746)+(2.016)+(5.012), (I-746)+(2.016)+(5.013), (I-746)+(2.016)+(5.014), (I-746)+(2.016)+(5.015), (I-746)+(2.016)+(5.016), (I-746)+(2.016)+(5.017), (I-746)+(2.016)+(5.018), (I-746)+(2.016)+(5.019), (I-746)+(2.016)+(5.020), (I-746)+(2.016)+(5.021), (I-746)+(2.016)+(5.022), (I-746)+(2.016)+(5.023), (I-746)+(2.016)+(6.001), (I-746)+(2.016)+(6.002), (I-746)+(2.016)+(6.003), (I-746)+(2.016)+(6.004), (I-746)+(2.016)+(7.001), (I-746)+(2.016)+(7.002), (I-746)+(2.016)+(7.003), (I-746)+(2.016)+(7.004), (I-746)+(2.016)+(7.005), (I-746)+(2.016)+(7.006), (I-746)+(2.016)+(9.001), (I-746)+(2.016)+(9.002), (I-746)+(2.016)+(9.003), (I-746)+(2.016)+(9.004), (I-746)+(2.016)+(9.005), (I-746)+(2.016)+(9.006), (I-746)+(2.016)+(9.007), (I-746)+(2.016)+(9.008), (I-746)+(2.016)+(9.009), (I-746)+(2.016)+(14.001), (I-746)+(2.016)+(14.002), (I-746)+(2.016)+(15.008), (I-746)+(2.016)+(15.011), (I-746)+(2.016)+(15.012), (I-746)+(2.016)+(15.016), (I-746)+(2.016)+(15.025), (I-746)+(2.016)+(15.027), (I-746)+(2.016)+(15.047), (I-746)+(2.016)+(15.063), (I-746)+(2.016)+(15.064), (I-746)+(2.016)+(16.001), (I-746)+(2.016)+(16.002), (I-746)+(2.016)+(16.003), (I-746)+(2.016)+(16.004), (I-746)+(2.016)+(16.005), (I-746)+(2.016)+(16.006), (I-746)+(2.016)+(16.007), (I-746)+(2.016)+(16.008), (I-746)+(2.016)+(17.001), (I-746)+(2.016)+(17.002), (I-746)+(2.016)+(17.003), (I-746)+(2.016)+(17.004), (I-746)+(2.016)+(17.005), (I-746)+(2.016)+(17.006), (I-746)+(2.016)+(17.007), (I-746)+(2.016)+(17.008), (I-746)+(2.016)+(17.009), (I-746)+(2.016)+(17.010), (I-746)+(2.016)+(17.011), (I-746)+(2.016)+(17.012), (I-746)+(2.016)+(18.001),

(I-746)+(2.017)+(3.001), (I-746)+(2.017)+(3.002), (I-746)+(2.017)+(3.003), (I-746)+(2.017)+(3.004), (I-746)+(2.017)+(3.005), (I-746)+(2.017)+(3.006), (I-746)+(2.017)+(3.007), (I-746)+(2.017)+(3.008), (I-746)+(2.017)+(3.009), (I-746)+(2.017)+(3.010), (I-746)+(2.017)+(3.011), (I-746)+(2.017)+(3.012), (I-746)+(2.017)+(3.013), (I-746)+(2.017)+(3.014), (I-746)+(2.017)+(3.015), (I-746)+(2.017)+(3.016), (I-746)+(2.017)+(3.017), (I-746)+(2.017)+(3.018), (I-746)+(2.017)+(3.019), (I-746)+(2.017)+(3.020), (I-746)+(2.017)+(3.021), (I-746)+(2.017)+(3.022), (I-746)+(2.017)+(3.023), (I-746)+(2.017)+(3.024), (I-746)+(2.017)+(3.025), (I-746)+(2.017)+(3.026), (I-746)+(2.017)+(3.027), (I-746)+(2.017)+(3.028), (I-746)+(2.017)+(3.029), (I-746)+(2.017)+(3.030), (I-746)+(2.017)+(3.031), (I-746)+(2.017)+(5.001), (I-746)+(2.017)+(5.002), (I-746)+(2.017)+(5.003), (I-746)+(2.017)+(5.004), (I-746)+(2.017)+(5.005), (I-746)+(2.017)+(5.006), (I-746)+(2.017)+(5.007), (I-746)+(2.017)+(5.008), (I-746)+(2.017)+(5.009), (I-746)+(2.017)+(5.010), (I-746)+(2.017)+(5.011), (I-746)+(2.017)+(5.012), (I-746)+(2.017)+(5.013), (I-746)+(2.017)+(5.014), (I-746)+(2.017)+(5.015), (I-746)+(2.017)+(5.016), (I-746)+(2.017)+(5.017), (I-746)+(2.017)+(5.018), (I-746)+(2.017)+(5.019), (I-746)+(2.017)+(5.020), (I-746)+(2.017)+(5.021), (I-746)+(2.017)+(5.022), (I-746)+(2.017)+(5.023), (I-746)+(2.017)+(6.001), (I-746)+(2.017)+(6.002), (I-746)+(2.017)+(6.003), (I-746)+(2.017)+(6.004), (I-746)+(2.017)+(7.001), (I-746)+(2.017)+(7.002), (I-746)+(2.017)+(7.003), (I-746)+(2.017)+(7.004), (I-746)+(2.017)+(7.005), (I-746)+(2.017)+(7.006), (I-746)+(2.017)+(9.001), (I-746)+(2.017)+(9.002), (I-746)+(2.017)+(9.003), (I-746)+(2.017)+(9.004), (I-746)+(2.017)+(9.005), (I-746)+(2.017)+(9.006), (I-746)+(2.017)+(9.007), (I-746)+(2.017)+(9.008), (I-746)+(2.017)+(9.009), (I-746)+(2.017)+(14.001), (I-746)+(2.017)+(14.002), (I-746)+(2.017)+(15.008), (I-746)+(2.017)+(15.011), (I-746)+(2.017)+(15.012), (I-746)+(2.017)+(15.016), (I-746)+(2.017)+(15.025), (I-746)+(2.017)+(15.027), (I-746)+(2.017)+(15.047), (I-746)+(2.017)+(15.063), (I-746)+(2.017)+(15.064), (I-746)+(2.017)+(16.001), (I-746)+(2.017)+(16.002), (I-746)+(2.017)+(16.003), (I-746)+(2.017)+(16.004), (I-746)+(2.017)+(16.005), (I-746)+(2.017)+(16.006), (I-746)+(2.017)+(16.007), (I-746)+(2.017)+(16.008), (I-746)+(2.017)+(17.001), (I-746)+(2.017)+(17.002), (I-746)+(2.017)+(17.003), (I-746)+(2.017)+(17.004), (I-746)+(2.017)+(17.005), (I-746)+(2.017)+(17.006), (I-746)+(2.017)+(17.007), (I-746)+(2.017)+(17.008), (I-746)+(2.017)+(17.009), (I-746)+(2.017)+(17.010), (I-746)+(2.017)+(17.011), (I-746)+(2.017)+(17.012), (I-746)+(2.017)+(18.001),

(I-746)+(2.018)+(3.001), (I-746)+(2.018)+(3.002), (I-746)+(2.018)+(3.003), (I-746)+(2.018)+(3.004), (I-746)+(2.018)+(3.005), (I-746)+(2.018)+(3.006), (I-746)+(2.018)+(3.007), (I-746)+(2.018)+(3.008), (I-746)+(2.018)+(3.009), (I-746)+(2.018)+(3.010), (I-746)+(2.018)+(3.011), (I-746)+(2.018)+(3.012), (I-746)+(2.018)+(3.013), (I-746)+(2.018)+(3.014), (I-746)+(2.018)+(3.015), (I-746)+(2.018)+(3.016), (I-746)+(2.018)+(3.017), (I-746)+(2.018)+(3.018), (I-746)+(2.018)+(3.019), (I-746)+(2.018)+(3.020), (I-746)+(2.018)+(3.021), (I-746)+(2.018)+(3.022), (I-746)+(2.018)+(3.023), (I-746)+(2.018)+(3.024), (I-746)+(2.018)+(3.025), (I-746)+(2.018)+(3.026), (I-746)+(2.018)+(3.027), (I-746)+(2.018)+(3.028), (I-746)+(2.018)+(3.029), (I-746)+(2.018)+(3.030), (I-746)+(2.018)+(3.031), (I-746)+(2.018)+(5.001), (I-746)+(2.018)+(5.002), (I-746)+(2.018)+(5.003), (I-746)+(2.018)+(5.004), (I-746)+(2.018)+(5.005), (I-746)+(2.018)+(5.006), (I-746)+(2.018)+(5.007), (I-746)+(2.018)+(5.008), (I-746)+(2.018)+(5.009), (I-746)+(2.018)+(5.010), (I-746)+(2.018)+(5.011), (I-746)+(2.018)+(5.012), (I-746)+(2.018)+(5.013), (I-746)+(2.018)+(5.014), (I-746)+(2.018)+(5.015), (I-746)+(2.018)+(5.016), (I-746)+(2.018)+(5.017), (I-746)+(2.018)+(5.018), (I-746)+(2.018)+(5.019), (I-746)+(2.018)+(5.020), (I-746)+(2.018)+(5.021), (I-746)+(2.018)+(5.022), (I-746)+(2.018)+(5.023), (I-746)+(2.018)+(6.001), (I-746)+(2.018)+(6.002), (I-746)+(2.018)+(6.003), (I-746)+(2.018)+(6.004), (I-746)+(2.018)+(7.001), (I-746)+(2.018)+(7.002), (I-746)+(2.018)+(7.003), (I-746)+(2.018)+(7.004), (I-746)+(2.018)+(7.005), (I-746)+(2.018)+(7.006), (I-746)+(2.018)+(9.001), (I-746)+(2.018)+(9.002), (I-746)+(2.018)+(9.003), (I-746)+(2.018)+(9.004), (I-746)+(2.018)+(9.005), (I-746)+(2.018)+(9.006), (I-746)+(2.018)+(9.007), (I-746)+(2.018)+(9.008), (I-746)+(2.018)+(9.009), (I-746)+(2.018)+(14.001), (I-746)+(2.018)+(14.002), (I-746)+(2.018)+(15.008), (I-746)+(2.018)+(15.011), (I-746)+(2.018)+(15.012), (I-746)+(2.018)+(15.016), (I-746)+(2.018)+(15.025), (I-746)+(2.018)+(15.027), (I-746)+(2.018)+(15.047), (I-746)+(2.018)+(15.063), (I-746)+(2.018)+(15.064), (I-746)+(2.018)+(16.001), (I-746)+(2.018)+(16.002), (I-746)+(2.018)+(16.003), (I-746)+(2.018)+(16.004), (I-746)+(2.018)+(16.005), (I-746)+(2.018)+(16.006), (I-746)+(2.018)+(16.007), (I-746)+(2.018)+(16.008), (I-746)+(2.018)+(17.001), (I-746)+(2.018)+(17.002), (I-746)+(2.018)+(17.003), (I-746)+(2.018)+(17.004), (I-746)+(2.018)+(17.005), (I-746)+(2.018)+(17.006), (I-746)+(2.018)+(17.007), (I-746)+(2.018)+(17.008), (I-746)+(2.018)+(17.009), (I-746)+(2.018)+(17.010), (I-746)+(2.018)+(17.011), (I-746)+(2.018)+(17.012), (I-746)+(2.018)+(18.001),

(I-746)+(2.019)+(3.001), (I-746)+(2.019)+(3.002), (I-746)+(2.019)+(3.003), (I-746)+(2.019)+(3.004), (I-746)+(2.019)+(3.005), (I-746)+(2.019)+(3.006), (I-746)+(2.019)+(3.007), (I-746)+(2.019)+(3.008), (I-746)+(2.019)+(3.009), (I-746)+(2.019)+(3.010), (I-746)+(2.019)+(3.011), (I-746)+(2.019)+(3.012), (I-746)+(2.019)+(3.013), (I-746)+(2.019)+(3.014), (I-746)+(2.019)+(3.015), (I-746)+(2.019)+(3.016), (I-746)+(2.019)+(3.017), (I-746)+(2.019)+(3.018), (I-746)+(2.019)+(3.019), (I-746)+(2.019)+(3.020), (I-746)+(2.019)+(3.021), (I-746)+(2.019)+(3.022), (I-746)+(2.019)+(3.023), (I-746)+(2.019)+(3.024), (I-746)+(2.019)+(3.025), (I-746)+(2.019)+(3.026), (I-746)+(2.019)+(3.027), (I-746)+(2.019)+(3.028), (I-746)+(2.019)+(3.029), (I-746)+(2.019)+(3.030), (I-746)+(2.019)+(3.031), (I-746)+(2.019)+(5.001), (I-746)+(2.019)+(5.002), (I-746)+(2.019)+(5.003), (I-746)+(2.019)+(5.004), (I-746)+(2.019)+(5.005), (I-746)+(2.019)+(5.006), (I-746)+(2.019)+(5.007), (I-746)+(2.019)+(5.008), (I-746)+(2.019)+(5.009), (I-746)+(2.019)+(5.010), (I-746)+(2.019)+(5.011), (I-746)+(2.019)+(5.012), (I-746)+(2.019)+(5.013), (I-746)+(2.019)+(5.014), (I-746)+(2.019)+(5.015), (I-746)+(2.019)+(5.016), (I-746)+(2.019)+(5.017), (I-746)+(2.019)+(5.018), (I-746)+(2.019)+(5.019), (I-746)+(2.019)+(5.020), (I-746)+(2.019)+(5.021), (I-746)+(2.019)+(5.022), (I-746)+(2.019)+(5.023), (I-746)+(2.019)+(6.001), (I-746)+(2.019)+(6.002), (I-746)+(2.019)+(6.003), (I-746)+(2.019)+(6.004), (I-746)+(2.019)+(7.001), (I-746)+(2.019)+(7.002), (I-746)+(2.019)+(7.003), (I-746)+(2.019)+(7.004), (I-746)+(2.019)+(7.005), (I-746)+(2.019)+(7.006), (I-746)+(2.019)+(9.001), (I-746)+(2.019)+(9.002), (I-746)+(2.019)+(9.003), (I-746)+(2.019)+(9.004), (I-746)+(2.019)+(9.005), (I-746)+(2.019)+(9.006), (I-746)+(2.019)+(9.007), (I-746)+(2.019)+(9.008), (I-746)+(2.019)+(9.009), (I-746)+(2.019)+(14.001), (I-746)+(2.019)+(14.002), (I-746)+(2.019)+(15.008), (I-746)+(2.019)+(15.011), (I-746)+(2.019)+(15.012), (I-746)+(2.019)+(15.016), (I-746)+(2.019)+(15.025), (I-746)+(2.019)+(15.027), (I-746)+(2.019)+(15.047), (I-746)+(2.019)+(15.063), (I-746)+(2.019)+(15.064), (I-746)+(2.019)+(16.001), (I-746)+(2.019)+(16.002), (I-746)+(2.019)+(16.003), (I-746)+(2.019)+(16.004), (I-746)+(2.019)+(16.005), (I-746)+(2.019)+(16.006), (I-746)+(2.019)+(16.007), (I-746)+(2.019)+(16.008), (I-746)+(2.019)+(17.001), (I-746)+(2.019)+(17.002), (I-746)+(2.019)+(17.003), (I-746)+(2.019)+(17.004), (I-746)+(2.019)+(17.005), (I-746)+(2.019)+(17.006), (I-746)+(2.019)+(17.007), (I-746)+(2.019)+(17.008), (I-746)+(2.019)+(17.009), (I-746)+(2.019)+(17.010), (I-746)+(2.019)+(17.011), (I-746)+(2.019)+(17.012), (I-746)+(2.019)+(18.001),

(I-746)+(2.020)+(3.001), (I-746)+(2.020)+(3.002), (I-746)+(2.020)+(3.003), (I-746)+(2.020)+(3.004), (I-746)+(2.020)+(3.005), (I-746)+(2.020)+(3.006), (I-746)+(2.020)+(3.007), (I-746)+(2.020)+(3.008), (I-746)+(2.020)+(3.009), (I-746)+(2.020)+(3.010), (I-746)+(2.020)+(3.011), (I-746)+(2.020)+(3.012), (I-746)+(2.020)+(3.013), (I-746)+(2.020)+(3.014), (I-746)+(2.020)+(3.015), (I-746)+(2.020)+(3.016), (I-746)+(2.020)+(3.017), (I-746)+(2.020)+(3.018), (I-746)+(2.020)+(3.019), (I-746)+(2.020)+(3.020), (I-746)+(2.020)+(3.021), (I-746)+(2.020)+(3.022), (I-746)+(2.020)+(3.023), (I-746)+(2.020)+(3.024), (I-746)+(2.020)+(3.025), (I-746)+(2.020)+(3.026), (I-746)+(2.020)+(3.027), (I-746)+(2.020)+(3.028), (I-746)+(2.020)+(3.029), (I-746)+(2.020)+(3.030), (I-746)+(2.020)+(3.031), (I-746)+(2.020)+(5.001), (I-746)+(2.020)+(5.002), (I-746)+(2.020)+(5.003), (I-746)+(2.020)+(5.004), (I-746)+(2.020)+(5.005), (I-746)+(2.020)+(5.006), (I-746)+(2.020)+(5.007), (I-746)+(2.020)+(5.008), (I-746)+(2.020)+(5.009), (I-746)+(2.020)+(5.010), (I-746)+(2.020)+(5.011), (I-746)+(2.020)+(5.012), (I-746)+(2.020)+(5.013), (I-746)+(2.020)+(5.014), (I-746)+(2.020)+(5.015), (I-746)+(2.020)+(5.016), (I-746)+(2.020)+(5.017), (I-746)+(2.020)+(5.018), (I-746)+(2.020)+(5.019), (I-746)+(2.020)+(5.020), (I-746)+(2.020)+(5.021), (I-746)+(2.020)+(5.022), (I-746)+(2.020)+(5.023), (I-746)+(2.020)+(6.001), (I-746)+(2.020)+(6.002), (I-746)+(2.020)+(6.003), (I-746)+(2.020)+(6.004), (I-746)+(2.020)+(7.001), (I-746)+(2.020)+(7.002), (I-746)+(2.020)+(7.003), (I-746)+(2.020)+(7.004), (I-746)+(2.020)+(7.005), (I-746)+(2.020)+(7.006), (I-746)+(2.020)+(9.001), (I-746)+(2.020)+(9.002), (I-746)+(2.020)+(9.003), (I-746)+(2.020)+(9.004), (I-746)+(2.020)+(9.005), (I-746)+(2.020)+(9.006), (I-746)+(2.020)+(9.007), (I-746)+(2.020)+(9.008), (I-746)+(2.020)+(9.009), (I-746)+(2.020)+(14.001), (I-746)+(2.020)+(14.002), (I-746)+(2.020)+(15.008), (I-746)+(2.020)+(15.011), (I-746)+(2.020)+(15.012), (I-746)+(2.020)+(15.016), (I-746)+(2.020)+(15.025), (I-746)+(2.020)+(15.027), (I-746)+(2.020)+(15.047), (I-746)+(2.020)+(15.063), (I-746)+(2.020)+(15.064), (I-746)+(2.020)+(16.001), (I-746)+(2.020)+(16.002), (I-746)+(2.020)+(16.003), (I-746)+(2.020)+(16.004), (I-746)+(2.020)+(16.005), (I-746)+(2.020)+(16.006), (I-746)+(2.020)+(16.007), (I-746)+(2.020)+(16.008), (I-746)+(2.020)+(17.001), (I-746)+(2.020)+(17.002), (I-746)+(2.020)+(17.003), (I-746)+(2.020)+(17.004), (I-746)+(2.020)+(17.005), (I-746)+(2.020)+(17.006), (I-746)+(2.020)+(17.007), (I-746)+(2.020)+(17.008), (I-746)+(2.020)+(17.009), (I-746)+(2.020)+(17.010), (I-746)+(2.020)+(17.011), (I-746)+(2.020)+(17.012), (I-746)+(2.020)+(18.001),

(I-746)+(2.021)+(3.001), (I-746)+(2.021)+(3.002), (I-746)+(2.021)+(3.003), (I-746)+(2.021)+(3.004), (I-746)+(2.021)+(3.005), (I-746)+(2.021)+(3.006), (I-746)+(2.021)+(3.007), (I-746)+(2.021)+(3.008), (I-746)+(2.021)+(3.009), (I-746)+(2.021)+(3.010), (I-746)+(2.021)+(3.011), (I-746)+(2.021)+(3.012), (I-746)+(2.021)+(3.013), (I-746)+(2.021)+(3.014), (I-746)+(2.021)+(3.015), (I-746)+(2.021)+(3.016), (I-746)+(2.021)+(3.017), (I-746)+(2.021)+(3.018), (I-746)+(2.021)+(3.019), (I-746)+(2.021)+(3.020), (I-746)+(2.021)+(3.021), (I-746)+(2.021)+(3.022), (I-746)+(2.021)+(3.023), (I-746)+(2.021)+(3.024), (I-746)+(2.021)+(3.025), (I-746)+(2.021)+(3.026), (I-746)+(2.021)+(3.027), (I-746)+(2.021)+(3.028), (I-746)+(2.021)+(3.029), (I-746)+(2.021)+(3.030), (I-746)+(2.021)+(3.031), (I-746)+(2.021)+(5.001), (I-746)+(2.021)+(5.002), (I-746)+(2.021)+(5.003), (I-746)+(2.021)+(5.004), (I-746)+(2.021)+(5.005), (I-746)+(2.021)+(5.006), (I-746)+(2.021)+(5.007), (I-746)+(2.021)+(5.008), (I-746)+(2.021)+(5.009), (I-746)+(2.021)+(5.010), (I-746)+(2.021)+(5.011), (I-746)+(2.021)+(5.012), (I-746)+(2.021)+(5.013), (I-746)+(2.021)+(5.014), (I-746)+(2.021)+(5.015), (I-746)+(2.021)+(5.016), (I-746)+(2.021)+(5.017), (I-746)+(2.021)+(5.018), (I-746)+(2.021)+(5.019), (I-746)+(2.021)+(5.020), (I-746)+(2.021)+(5.021), (I-746)+(2.021)+(5.022), (I-746)+(2.021)+(5.023), (I-746)+(2.021)+(6.001), (I-746)+(2.021)+(6.002), (I-746)+(2.021)+(6.003), (I-746)+(2.021)+(6.004), (I-746)+(2.021)+(7.001), (I-746)+(2.021)+(7.002), (I-746)+(2.021)+(7.003), (I-746)+(2.021)+(7.004), (I-746)+(2.021)+(7.005), (I-746)+(2.021)+(7.006), (I-746)+(2.021)+(9.001), (I-746)+(2.021)+(9.002), (I-746)+(2.021)+(9.003), (I-746)+(2.021)+(9.004), (I-746)+(2.021)+(9.005), (I-746)+(2.021)+(9.006), (I-746)+(2.021)+(9.007), (I-746)+(2.021)+(9.008), (I-746)+(2.021)+(9.009), (I-746)+(2.021)+(14.001), (I-746)+(2.021)+(14.002), (I-746)+(2.021)+(15.008), (I-746)+(2.021)+(15.011), (I-746)+(2.021)+(15.012), (I-746)+(2.021)+(15.016), (I-746)+(2.021)+(15.025), (I-746)+(2.021)+(15.027), (I-746)+(2.021)+(15.047), (I-746)+(2.021)+(15.063), (I-746)+(2.021)+(15.064), (I-746)+(2.021)+(16.001), (I-746)+(2.021)+(16.002), (I-746)+(2.021)+(16.003), (I-746)+(2.021)+(16.004), (I-746)+(2.021)+(16.005), (I-746)+(2.021)+(16.006), (I-746)+(2.021)+(16.007), (I-746)+(2.021)+(16.008), (I-746)+(2.021)+(17.001), (I-746)+(2.021)+(17.002), (I-746)+(2.021)+(17.003), (I-746)+(2.021)+(17.004), (I-746)+(2.021)+(17.005), (I-746)+(2.021)+(17.006), (I-746)+(2.021)+(17.007), (I-746)+(2.021)+(17.008), (I-746)+(2.021)+(17.009), (I-746)+(2.021)+(17.010), (I-746)+(2.021)+(17.011), (I-746)+(2.021)+(17.012), (I-746)+(2.021)+(18.001),

(I-746)+(2.022)+(3.001), (I-746)+(2.022)+(3.002), (I-746)+(2.022)+(3.003), (I-746)+(2.022)+(3.004), (I-746)+(2.022)+(3.005), (I-746)+(2.022)+(3.006), (I-746)+(2.022)+(3.007), (I-746)+(2.022)+(3.008), (I-746)+(2.022)+(3.009), (I-746)+(2.022)+(3.010), (I-746)+(2.022)+(3.011), (I-746)+(2.022)+(3.012), (I-746)+(2.022)+(3.013), (I-746)+(2.022)+(3.014), (I-746)+(2.022)+(3.015), (I-746)+(2.022)+(3.016), (I-746)+(2.022)+(3.017), (I-746)+(2.022)+(3.018), (I-746)+(2.022)+(3.019), (I-746)+(2.022)+(3.020), (I-746)+(2.022)+(3.021), (I-746)+(2.022)+(3.022), (I-746)+(2.022)+(3.023), (I-746)+(2.022)+(3.024), (I-746)+(2.022)+(3.025), (I-746)+(2.022)+(3.026), (I-746)+(2.022)+(3.027), (I-746)+(2.022)+(3.028), (I-746)+(2.022)+(3.029), (I-746)+(2.022)+(3.030), (I-746)+(2.022)+(3.031), (I-746)+(2.022)+(5.001), (I-746)+(2.022)+(5.002), (I-746)+(2.022)+(5.003), (I-746)+(2.022)+(5.004), (I-746)+(2.022)+(5.005), (I-746)+(2.022)+(5.006), (I-746)+(2.022)+(5.007), (I-746)+(2.022)+(5.008), (I-746)+(2.022)+(5.009), (I-746)+(2.022)+(5.010), (I-746)+(2.022)+(5.011), (I-746)+(2.022)+(5.012), (I-746)+(2.022)+(5.013), (I-746)+(2.022)+(5.014), (I-746)+(2.022)+(5.015), (I-746)+(2.022)+(5.016), (I-746)+(2.022)+(5.017), (I-746)+(2.022)+(5.018), (I-746)+(2.022)+(5.019), (I-746)+(2.022)+(5.020), (I-746)+(2.022)+(5.021), (I-746)+(2.022)+(5.022), (I-746)+(2.022)+(5.023), (I-746)+(2.022)+(6.001), (I-746)+(2.022)+(6.002), (I-746)+(2.022)+(6.003), (I-746)+(2.022)+(6.004), (I-746)+(2.022)+(7.001), (I-746)+(2.022)+(7.002), (I-746)+(2.022)+(7.003), (I-746)+(2.022)+(7.004), (I-746)+(2.022)+(7.005), (I-746)+(2.022)+(7.006), (I-746)+(2.022)+(9.001), (I-746)+(2.022)+(9.002), (I-746)+(2.022)+(9.003), (I-746)+(2.022)+(9.004), (I-746)+(2.022)+(9.005), (I-746)+(2.022)+(9.006), (I-746)+(2.022)+(9.007), (I-746)+(2.022)+(9.008), (I-746)+(2.022)+(9.009), (I-746)+(2.022)+(14.001), (I-746)+(2.022)+(14.002), (I-746)+(2.022)+(15.008), (I-746)+(2.022)+(15.011), (I-746)+(2.022)+(15.012), (I-746)+(2.022)+(15.016), (I-746)+(2.022)+(15.025), (I-746)+(2.022)+(15.027), (I-746)+(2.022)+(15.047), (I-746)+(2.022)+(15.063), (I-746)+(2.022)+(15.064), (I-746)+(2.022)+(16.001), (I-746)+(2.022)+(16.002), (I-746)+(2.022)+(16.003), (I-746)+(2.022)+(16.004), (I-746)+(2.022)+(16.005), (I-746)+(2.022)+(16.006), (I-746)+(2.022)+(16.007), (I-746)+(2.022)+(16.008), (I-746)+(2.022)+(17.001), (I-746)+(2.022)+(17.002), (I-746)+(2.022)+(17.003), (I-746)+(2.022)+(17.004), (I-746)+(2.022)+(17.005), (I-746)+(2.022)+(17.006), (I-746)+(2.022)+(17.007), (I-746)+(2.022)+(17.008), (I-746)+(2.022)+(17.009), (I-746)+(2.022)+(17.010), (I-746)+(2.022)+(17.011), (I-746)+(2.022)+(17.012), (I-746)+(2.022)+(18.001),

(I-746)+(2.023)+(3.001), (I-746)+(2.023)+(3.002), (I-746)+(2.023)+(3.003), (I-746)+(2.023)+(3.004), (I-746)+(2.023)+(3.005), (I-746)+(2.023)+(3.006), (I-746)+(2.023)+(3.007), (I-746)+(2.023)+(3.008), (I-746)+(2.023)+(3.009), (I-746)+(2.023)+(3.010), (I-746)+(2.023)+(3.011), (I-746)+(2.023)+(3.012), (I-746)+(2.023)+(3.013), (I-746)+(2.023)+(3.014), (I-746)+(2.023)+(3.015), (I-746)+(2.023)+(3.016), (I-746)+(2.023)+(3.017), (I-746)+(2.023)+(3.018), (I-746)+(2.023)+(3.019), (I-746)+(2.023)+(3.020), (I-746)+(2.023)+(3.021), (I-746)+(2.023)+(3.022), (I-746)+(2.023)+(3.023), (I-746)+(2.023)+(3.024), (I-746)+(2.023)+(3.025), (I-746)+(2.023)+(3.026), (I-746)+(2.023)+(3.027), (I-746)+(2.023)+(3.028), (I-746)+(2.023)+(3.029), (I-746)+(2.023)+(3.030), (I-746)+(2.023)+(3.031), (I-746)+(2.023)+(5.001), (I-746)+(2.023)+(5.002), (I-746)+(2.023)+(5.003), (I-746)+(2.023)+(5.004), (I-746)+(2.023)+(5.005), (I-746)+(2.023)+(5.006), (I-746)+(2.023)+(5.007), (I-746)+(2.023)+(5.008), (I-746)+(2.023)+(5.009), (I-746)+(2.023)+(5.010), (I-746)+(2.023)+(5.011), (I-746)+(2.023)+(5.012), (I-746)+(2.023)+(5.013), (I-746)+(2.023)+(5.014), (I-746)+(2.023)+(5.015), (I-746)+(2.023)+(5.016), (I-746)+(2.023)+(5.017), (I-746)+(2.023)+(5.018), (I-746)+(2.023)+(5.019), (I-746)+(2.023)+(5.020), (I-746)+(2.023)+(5.021), (I-746)+(2.023)+(5.022), (I-746)+(2.023)+(5.023), (I-746)+(2.023)+(6.001), (I-746)+(2.023)+(6.002), (I-746)+(2.023)+(6.003), (I-746)+(2.023)+(6.004), (I-746)+(2.023)+(7.001), (I-746)+(2.023)+(7.002), (I-746)+(2.023)+(7.003), (I-746)+(2.023)+(7.004), (I-746)+(2.023)+(7.005), (I-746)+(2.023)+(7.006), (I-746)+(2.023)+(9.001), (I-746)+(2.023)+(9.002), (I-746)+(2.023)+(9.003), (I-746)+(2.023)+(9.004), (I-746)+(2.023)+(9.005), (I-746)+(2.023)+(9.006), (I-746)+(2.023)+(9.007), (I-746)+(2.023)+(9.008), (I-746)+(2.023)+(9.009), (I-746)+(2.023)+(14.001), (I-746)+(2.023)+(14.002), (I-746)+(2.023)+(15.008), (I-746)+(2.023)+(15.011), (I-746)+(2.023)+(15.012), (I-746)+(2.023)+(15.016), (I-746)+(2.023)+(15.025), (I-746)+(2.023)+(15.027), (I-746)+(2.023)+(15.047), (I-746)+(2.023)+(15.063), (I-746)+(2.023)+(15.064), (I-746)+(2.023)+(16.001), (I-746)+(2.023)+(16.002), (I-746)+(2.023)+(16.003), (I-746)+(2.023)+(16.004), (I-746)+(2.023)+(16.005), (I-746)+(2.023)+(16.006), (I-746)+(2.023)+(16.007), (I-746)+(2.023)+(16.008), (I-746)+(2.023)+(17.001), (I-746)+(2.023)+(17.002), (I-746)+(2.023)+(17.003), (I-746)+(2.023)+(17.004), (I-746)+(2.023)+(17.005), (I-746)+(2.023)+(17.006), (I-746)+(2.023)+(17.007), (I-746)+(2.023)+(17.008), (I-746)+(2.023)+(17.009), (I-746)+(2.023)+(17.010), (I-746)+(2.023)+(17.011), (I-746)+(2.023)+(17.012), (I-746)+(2.023)+(18.001),

(I-746)+(2.024)+(3.001), (I-746)+(2.024)+(3.002), (I-746)+(2.024)+(3.003), (I-746)+(2.024)+(3.004), (I-746)+(2.024)+(3.005), (I-746)+(2.024)+(3.006), (I-746)+(2.024)+(3.007), (I-746)+(2.024)+(3.008), (I-746)+(2.024)+(3.009), (I-746)+(2.024)+(3.010), (I-746)+(2.024)+(3.011), (I-746)+(2.024)+(3.012), (I-746)+(2.024)+(3.013), (I-746)+(2.024)+(3.014), (I-746)+(2.024)+(3.015), (I-746)+(2.024)+(3.016), (I-746)+(2.024)+(3.017), (I-746)+(2.024)+(3.018), (I-746)+(2.024)+(3.019), (I-746)+(2.024)+(3.020), (I-746)+(2.024)+(3.021), (I-746)+(2.024)+(3.022), (I-746)+(2.024)+(3.023), (I-746)+(2.024)+(3.024), (I-746)+(2.024)+(3.025), (I-746)+(2.024)+(3.026), (I-746)+(2.024)+(3.027), (I-746)+(2.024)+(3.028), (I-746)+(2.024)+(3.029), (I-746)+(2.024)+(3.030), (I-746)+(2.024)+(3.031), (I-746)+(2.024)+(5.001), (I-746)+(2.024)+(5.002), (I-746)+(2.024)+(5.003), (I-746)+(2.024)+(5.004), (I-746)+(2.024)+(5.005), (I-746)+(2.024)+(5.006), (I-746)+(2.024)+(5.007), (I-746)+(2.024)+(5.008), (I-746)+(2.024)+(5.009), (I-746)+(2.024)+(5.010), (I-746)+(2.024)+(5.011), (I-746)+(2.024)+(5.012), (I-746)+(2.024)+(5.013), (I-746)+(2.024)+(5.014), (I-746)+(2.024)+(5.015), (I-746)+(2.024)+(5.016), (I-746)+(2.024)+(5.017), (I-746)+(2.024)+(5.018), (I-746)+(2.024)+(5.019), (I-746)+(2.024)+(5.020), (I-746)+(2.024)+(5.021), (I-746)+(2.024)+(5.022), (I-746)+(2.024)+(5.023), (I-746)+(2.024)+(6.001), (I-746)+(2.024)+(6.002), (I-746)+(2.024)+(6.003), (I-746)+(2.024)+(6.004), (I-746)+(2.024)+(7.001), (I-746)+(2.024)+(7.002), (I-746)+(2.024)+(7.003), (I-746)+(2.024)+(7.004), (I-746)+(2.024)+(7.005), (I-746)+(2.024)+(7.006), (I-746)+(2.024)+(9.001), (I-746)+(2.024)+(9.002), (I-746)+(2.024)+(9.003), (I-746)+(2.024)+(9.004), (I-746)+(2.024)+(9.005), (I-746)+(2.024)+(9.006), (I-746)+(2.024)+(9.007), (I-746)+(2.024)+(9.008), (I-746)+(2.024)+(9.009), (I-746)+(2.024)+(14.001), (I-746)+(2.024)+(14.002), (I-746)+(2.024)+(15.008), (I-746)+(2.024)+(15.011), (I-746)+(2.024)+(15.012), (I-746)+(2.024)+(15.016), (I-746)+(2.024)+(15.025), (I-746)+(2.024)+(15.027), (I-746)+(2.024)+(15.047), (I-746)+(2.024)+(15.063), (I-746)+(2.024)+(15.064), (I-746)+(2.024)+(16.001), (I-746)+(2.024)+(16.002), (I-746)+(2.024)+(16.003), (I-746)+(2.024)+(16.004), (I-746)+(2.024)+(16.005), (I-746)+(2.024)+(16.006), (I-746)+(2.024)+(16.007), (I-746)+(2.024)+(16.008), (I-746)+(2.024)+(17.001), (I-746)+(2.024)+(17.002), (I-746)+(2.024)+(17.003), (I-746)+(2.024)+(17.004), (I-746)+(2.024)+(17.005), (I-746)+(2.024)+(17.006), (I-746)+(2.024)+(17.007), (I-746)+(2.024)+(17.008), (I-746)+(2.024)+(17.009), (I-746)+(2.024)+(17.010), (I-746)+(2.024)+(17.011), (I-746)+(2.024)+(17.012), (I-746)+(2.024)+(18.001),

(I-746)+(2.025)+(3.001), (I-746)+(2.025)+(3.002), (I-746)+(2.025)+(3.003), (I-746)+(2.025)+(3.004), (I-746)+(2.025)+(3.005), (I-746)+(2.025)+(3.006), (I-746)+(2.025)+(3.007), (I-746)+(2.025)+(3.008), (I-746)+(2.025)+(3.009), (I-746)+(2.025)+(3.010), (I-746)+(2.025)+(3.011), (I-746)+(2.025)+(3.012), (I-746)+(2.025)+(3.013), (I-746)+(2.025)+(3.014), (I-746)+(2.025)+(3.015), (I-746)+(2.025)+(3.016), (I-746)+(2.025)+(3.017), (I-746)+(2.025)+(3.018), (I-746)+(2.025)+(3.019), (I-746)+(2.025)+(3.020), (I-746)+(2.025)+(3.021), (I-746)+(2.025)+(3.022), (I-746)+(2.025)+(3.023), (I-746)+(2.025)+(3.024), (I-746)+(2.025)+(3.025), (I-746)+(2.025)+(3.026), (I-746)+(2.025)+(3.027), (I-746)+(2.025)+(3.028), (I-746)+(2.025)+(3.029), (I-746)+(2.025)+(3.030), (I-746)+(2.025)+(3.031), (I-746)+(2.025)+(5.001), (I-746)+(2.025)+(5.002), (I-746)+(2.025)+(5.003), (I-746)+(2.025)+(5.004), (I-746)+(2.025)+(5.005), (I-746)+(2.025)+(5.006), (I-746)+(2.025)+(5.007), (I-746)+(2.025)+(5.008), (I-746)+(2.025)+(5.009), (I-746)+(2.025)+(5.010), (I-746)+(2.025)+(5.011), (I-746)+(2.025)+(5.012), (I-746)+(2.025)+(5.013), (I-746)+(2.025)+(5.014), (I-746)+(2.025)+(5.015), (I-746)+(2.025)+(5.016), (I-746)+(2.025)+(5.017), (I-746)+(2.025)+(5.018), (I-746)+(2.025)+(5.019), (I-746)+(2.025)+(5.020), (I-746)+(2.025)+(5.021), (I-746)+(2.025)+(5.022), (I-746)+(2.025)+(5.023), (I-746)+(2.025)+(6.001), (I-746)+(2.025)+(6.002), (I-746)+(2.025)+(6.003), (I-746)+(2.025)+(6.004), (I-746)+(2.025)+(7.001), (I-746)+(2.025)+(7.002), (I-746)+(2.025)+(7.003), (I-746)+(2.025)+(7.004), (I-746)+(2.025)+(7.005), (I-746)+(2.025)+(7.006), (I-746)+(2.025)+(9.001), (I-746)+(2.025)+(9.002), (I-746)+(2.025)+(9.003), (I-746)+(2.025)+(9.004), (I-746)+(2.025)+(9.005), (I-746)+(2.025)+(9.006), (I-746)+(2.025)+(9.007), (I-746)+(2.025)+(9.008), (I-746)+(2.025)+(9.009), (I-746)+(2.025)+(14.001), (I-746)+(2.025)+(14.002), (I-746)+(2.025)+(15.008), (I-746)+(2.025)+(15.011), (I-746)+(2.025)+(15.012), (I-746)+(2.025)+(15.016), (I-746)+(2.025)+(15.025), (I-746)+(2.025)+(15.027), (I-746)+(2.025)+(15.047), (I-746)+(2.025)+(15.063), (I-746)+(2.025)+(15.064), (I-746)+(2.025)+(16.001), (I-746)+(2.025)+(16.002), (I-746)+(2.025)+(16.003), (I-746)+(2.025)+(16.004), (I-746)+(2.025)+(16.005), (I-746)+(2.025)+(16.006), (I-746)+(2.025)+(16.007), (I-746)+(2.025)+(16.008), (I-746)+(2.025)+(17.001), (I-746)+(2.025)+(17.002), (I-746)+(2.025)+(17.003), (I-746)+(2.025)+(17.004), (I-746)+(2.025)+(17.005), (I-746)+(2.025)+(17.006), (I-746)+(2.025)+(17.007), (I-746)+(2.025)+(17.008), (I-746)+(2.025)+(17.009), (I-746)+(2.025)+(17.010), (I-746)+(2.025)+(17.011), (I-746)+(2.025)+(17.012), (I-746)+(2.025)+(18.001),

(I-746)+(2.026)+(3.001), (I-746)+(2.026)+(3.002), (I-746)+(2.026)+(3.003), (I-746)+(2.026)+(3.004), (I-746)+(2.026)+(3.005), (I-746)+(2.026)+(3.006), (I-746)+(2.026)+(3.007), (I-746)+(2.026)+(3.008), (I-746)+(2.026)+(3.009), (I-746)+(2.026)+(3.010), (I-746)+(2.026)+(3.011), (I-746)+(2.026)+(3.012), (I-746)+(2.026)+(3.013), (I-746)+(2.026)+(3.014), (I-746)+(2.026)+(3.015), (I-746)+(2.026)+(3.016), (I-746)+(2.026)+(3.017), (I-746)+(2.026)+(3.018), (I-746)+(2.026)+(3.019), (I-746)+(2.026)+(3.020), (I-746)+(2.026)+(3.021), (I-746)+(2.026)+(3.022), (I-746)+(2.026)+(3.023), (I-746)+(2.026)+(3.024), (I-746)+(2.026)+(3.025), (I-746)+(2.026)+(3.026), (I-746)+(2.026)+(3.027), (I-746)+(2.026)+(3.028), (I-746)+(2.026)+(3.029), (I-746)+(2.026)+(3.030), (I-746)+(2.026)+(3.031), (I-746)+(2.026)+(5.001), (I-746)+(2.026)+(5.002), (I-746)+(2.026)+(5.003), (I-746)+(2.026)+(5.004), (I-746)+(2.026)+(5.005), (I-746)+(2.026)+(5.006), (I-746)+(2.026)+(5.007), (I-746)+(2.026)+(5.008), (I-746)+(2.026)+(5.009), (I-746)+(2.026)+(5.010), (I-746)+(2.026)+(5.011), (I-746)+(2.026)+(5.012), (I-746)+(2.026)+(5.013), (I-746)+(2.026)+(5.014), (I-746)+(2.026)+(5.015), (I-746)+(2.026)+(5.016), (I-746)+(2.026)+(5.017), (I-746)+(2.026)+(5.018), (I-746)+(2.026)+(5.019), (I-746)+(2.026)+(5.020), (I-746)+(2.026)+(5.021), (I-746)+(2.026)+(5.022), (I-746)+(2.026)+(5.023), (I-746)+(2.026)+(6.001), (I-746)+(2.026)+(6.002), (I-746)+(2.026)+(6.003), (I-746)+(2.026)+(6.004), (I-746)+(2.026)+(7.001), (I-746)+(2.026)+(7.002), (I-746)+(2.026)+(7.003), (I-746)+(2.026)+(7.004), (I-746)+(2.026)+(7.005), (I-746)+(2.026)+(7.006), (I-746)+(2.026)+(9.001), (I-746)+(2.026)+(9.002), (I-746)+(2.026)+(9.003), (I-746)+(2.026)+(9.004), (I-746)+(2.026)+(9.005), (I-746)+(2.026)+(9.006), (I-746)+(2.026)+(9.007), (I-746)+(2.026)+(9.008), (I-746)+(2.026)+(9.009), (I-746)+(2.026)+(14.001), (I-746)+(2.026)+(14.002), (I-746)+(2.026)+(15.008), (I-746)+(2.026)+(15.011), (I-746)+(2.026)+(15.012), (I-746)+(2.026)+(15.016), (I-746)+(2.026)+(15.025), (I-746)+(2.026)+(15.027), (I-746)+(2.026)+(15.047), (I-746)+(2.026)+(15.063), (I-746)+(2.026)+(15.064), (I-746)+(2.026)+(16.001), (I-746)+(2.026)+(16.002), (I-746)+(2.026)+(16.003), (I-746)+(2.026)+(16.004), (I-746)+(2.026)+(16.005), (I-746)+(2.026)+(16.006), (I-746)+(2.026)+(16.007), (I-746)+(2.026)+(16.008), (I-746)+(2.026)+(17.001), (I-746)+(2.026)+(17.002), (I-746)+(2.026)+(17.003), (I-746)+(2.026)+(17.004), (I-746)+(2.026)+(17.005), (I-746)+(2.026)+(17.006), (I-746)+(2.026)+(17.007), (I-746)+(2.026)+(17.008), (I-746)+(2.026)+(17.009), (I-746)+(2.026)+(17.010), (I-746)+(2.026)+(17.011), (I-746)+(2.026)+(17.012), (I-746)+(2.026)+(18.001),

(I-746)+(2.027)+(3.001), (I-746)+(2.027)+(3.002), (I-746)+(2.027)+(3.003), (I-746)+(2.027)+(3.004), (I-746)+(2.027)+(3.005), (I-746)+(2.027)+(3.006), (I-746)+(2.027)+(3.007), (I-746)+(2.027)+(3.008), (I-746)+(2.027)+(3.009), (I-746)+(2.027)+(3.010), (I-746)+(2.027)+(3.011), (I-746)+(2.027)+(3.012), (I-746)+(2.027)+(3.013), (I-746)+(2.027)+(3.014), (I-746)+(2.027)+(3.015), (I-746)+(2.027)+(3.016), (I-746)+(2.027)+(3.017), (I-746)+(2.027)+(3.018), (I-746)+(2.027)+(3.019), (I-746)+(2.027)+(3.020), (I-746)+(2.027)+(3.021), (I-746)+(2.027)+(3.022), (I-746)+(2.027)+(3.023), (I-746)+(2.027)+(3.024), (I-746)+(2.027)+(3.025), (I-746)+(2.027)+(3.026), (I-746)+(2.027)+(3.027), (I-746)+(2.027)+(3.028), (I-746)+(2.027)+(3.029), (I-746)+(2.027)+(3.030), (I-746)+(2.027)+(3.031), (I-746)+(2.027)+(5.001), (I-746)+(2.027)+(5.002), (I-746)+(2.027)+(5.003), (I-746)+(2.027)+(5.004), (I-746)+(2.027)+(5.005), (I-746)+(2.027)+(5.006), (I-746)+(2.027)+(5.007), (I-746)+(2.027)+(5.008), (I-746)+(2.027)+(5.009), (I-746)+(2.027)+(5.010), (I-746)+(2.027)+(5.011), (I-746)+(2.027)+(5.012), (I-746)+(2.027)+(5.013), (I-746)+(2.027)+(5.014), (I-746)+(2.027)+(5.015), (I-746)+(2.027)+(5.016), (I-746)+(2.027)+(5.017), (I-746)+(2.027)+(5.018), (I-746)+(2.027)+(5.019), (I-746)+(2.027)+(5.020), (I-746)+(2.027)+(5.021), (I-746)+(2.027)+(5.022), (I-746)+(2.027)+(5.023), (I-746)+(2.027)+(6.001), (I-746)+(2.027)+(6.002), (I-746)+(2.027)+(6.003), (I-746)+(2.027)+(6.004), (I-746)+(2.027)+(7.001), (I-746)+(2.027)+(7.002), (I-746)+(2.027)+(7.003), (I-746)+(2.027)+(7.004), (I-746)+(2.027)+(7.005), (I-746)+(2.027)+(7.006), (I-746)+(2.027)+(9.001), (I-746)+(2.027)+(9.002), (I-746)+(2.027)+(9.003), (I-746)+(2.027)+(9.004), (I-746)+(2.027)+(9.005), (I-746)+(2.027)+(9.006), (I-746)+(2.027)+(9.007), (I-746)+(2.027)+(9.008), (I-746)+(2.027)+(9.009), (I-746)+(2.027)+(14.001), (I-746)+(2.027)+(14.002), (I-746)+(2.027)+(15.008), (I-746)+(2.027)+(15.011), (I-746)+(2.027)+(15.012), (I-746)+(2.027)+(15.016), (I-746)+(2.027)+(15.025), (I-746)+(2.027)+(15.027), (I-746)+(2.027)+(15.047), (I-746)+(2.027)+(15.063), (I-746)+(2.027)+(15.064), (I-746)+(2.027)+(16.001), (I-746)+(2.027)+(16.002), (I-746)+(2.027)+(16.003), (I-746)+(2.027)+(16.004), (I-746)+(2.027)+(16.005), (I-746)+(2.027)+(16.006), (I-746)+(2.027)+(16.007), (I-746)+(2.027)+(16.008), (I-746)+(2.027)+(17.001), (I-746)+(2.027)+(17.002), (I-746)+(2.027)+(17.003), (I-746)+(2.027)+(17.004), (I-746)+(2.027)+(17.005), (I-746)+(2.027)+(17.006), (I-746)+(2.027)+(17.007), (I-746)+(2.027)+(17.008), (I-746)+(2.027)+(17.009), (I-746)+(2.027)+(17.010), (I-746)+(2.027)+(17.011), (I-746)+(2.027)+(17.012), (I-746)+(2.027)+(18.001),

(I-746)+(2.028)+(3.001), (I-746)+(2.028)+(3.002), (I-746)+(2.028)+(3.003), (I-746)+(2.028)+(3.004), (I-746)+(2.028)+(3.005), (I-746)+(2.028)+(3.006), (I-746)+(2.028)+(3.007), (I-746)+(2.028)+(3.008), (I-746)+(2.028)+(3.009), (I-746)+(2.028)+(3.010), (I-746)+(2.028)+(3.011), (I-746)+(2.028)+(3.012), (I-746)+(2.028)+(3.013), (I-746)+(2.028)+(3.014), (I-746)+(2.028)+(3.015), (I-746)+(2.028)+(3.016), (I-746)+(2.028)+(3.017), (I-746)+(2.028)+(3.018), (I-746)+(2.028)+(3.019), (I-746)+(2.028)+(3.020), (I-746)+(2.028)+(3.021), (I-746)+(2.028)+(3.022), (I-746)+(2.028)+(3.023), (I-746)+(2.028)+(3.024), (I-746)+(2.028)+(3.025), (I-746)+(2.028)+(3.026), (I-746)+(2.028)+(3.027), (I-746)+(2.028)+(3.028), (I-746)+(2.028)+(3.029), (I-746)+(2.028)+(3.030), (I-746)+(2.028)+(3.031), (I-746)+(2.028)+(5.001), (I-746)+(2.028)+(5.002), (I-746)+(2.028)+(5.003), (I-746)+(2.028)+(5.004), (I-746)+(2.028)+(5.005), (I-746)+(2.028)+(5.006), (I-746)+(2.028)+(5.007), (I-746)+(2.028)+(5.008), (I-746)+(2.028)+(5.009), (I-746)+(2.028)+(5.010), (I-746)+(2.028)+(5.011), (I-746)+(2.028)+(5.012), (I-746)+(2.028)+(5.013), (I-746)+(2.028)+(5.014), (I-746)+(2.028)+(5.015), (I-746)+(2.028)+(5.016), (I-746)+(2.028)+(5.017), (I-746)+(2.028)+(5.018), (I-746)+(2.028)+(5.019), (I-746)+(2.028)+(5.020), (I-746)+(2.028)+(5.021), (I-746)+(2.028)+(5.022), (I-746)+(2.028)+(5.023), (I-746)+(2.028)+(6.001), (I-746)+(2.028)+(6.002), (I-746)+(2.028)+(6.003), (I-746)+(2.028)+(6.004), (I-746)+(2.028)+(7.001), (I-746)+(2.028)+(7.002), (I-746)+(2.028)+(7.003), (I-746)+(2.028)+(7.004), (I-746)+(2.028)+(7.005), (I-746)+(2.028)+(7.006), (I-746)+(2.028)+(9.001), (I-746)+(2.028)+(9.002), (I-746)+(2.028)+(9.003), (I-746)+(2.028)+(9.004), (I-746)+(2.028)+(9.005), (I-746)+(2.028)+(9.006), (I-746)+(2.028)+(9.007), (I-746)+(2.028)+(9.008), (I-746)+(2.028)+(9.009), (I-746)+(2.028)+(14.001), (I-746)+(2.028)+(14.002), (I-746)+(2.028)+(15.008), (I-746)+(2.028)+(15.011), (I-746)+(2.028)+(15.012), (I-746)+(2.028)+(15.016), (I-746)+(2.028)+(15.025), (I-746)+(2.028)+(15.027), (I-746)+(2.028)+(15.047), (I-746)+(2.028)+(15.063), (I-746)+(2.028)+(15.064), (I-746)+(2.028)+(16.001), (I-746)+(2.028)+(16.002), (I-746)+(2.028)+(16.003), (I-746)+(2.028)+(16.004), (I-746)+(2.028)+(16.005), (I-746)+(2.028)+(16.006), (I-746)+(2.028)+(16.007), (I-746)+(2.028)+(16.008), (I-746)+(2.028)+(17.001), (I-746)+(2.028)+(17.002), (I-746)+(2.028)+(17.003), (I-746)+(2.028)+(17.004), (I-746)+(2.028)+(17.005), (I-746)+(2.028)+(17.006), (I-746)+(2.028)+(17.007), (I-746)+(2.028)+(17.008), (I-746)+(2.028)+(17.009), (I-746)+(2.028)+(17.010), (I-746)+(2.028)+(17.011), (I-746)+(2.028)+(17.012), (I-746)+(2.028)+(18.001),

(I-746)+(2.029)+(3.001), (I-746)+(2.029)+(3.002), (I-746)+(2.029)+(3.003), (I-746)+(2.029)+(3.004), (I-746)+(2.029)+(3.005), (I-746)+(2.029)+(3.006), (I-746)+(2.029)+(3.007), (I-746)+(2.029)+(3.008), (I-746)+(2.029)+(3.009), (I-746)+(2.029)+(3.010), (I-746)+(2.029)+(3.011), (I-746)+(2.029)+(3.012), (I-746)+(2.029)+(3.013), (I-746)+(2.029)+(3.014), (I-746)+(2.029)+(3.015), (I-746)+(2.029)+(3.016), (I-746)+(2.029)+(3.017), (I-746)+(2.029)+(3.018), (I-746)+(2.029)+(3.019), (I-746)+(2.029)+(3.020), (I-746)+(2.029)+(3.021), (I-746)+(2.029)+(3.022), (I-746)+(2.029)+(3.023), (I-746)+(2.029)+(3.024), (I-746)+(2.029)+(3.025), (I-746)+(2.029)+(3.026), (I-746)+(2.029)+(3.027), (I-746)+(2.029)+(3.028), (I-746)+(2.029)+(3.029), (I-746)+(2.029)+(3.030), (I-746)+(2.029)+(3.031), (I-746)+(2.029)+(5.001), (I-746)+(2.029)+(5.002), (I-746)+(2.029)+(5.003), (I-746)+(2.029)+(5.004), (I-746)+(2.029)+(5.005), (I-746)+(2.029)+(5.006), (I-746)+(2.029)+(5.007), (I-746)+(2.029)+(5.008), (I-746)+(2.029)+(5.009), (I-746)+(2.029)+(5.010), (I-746)+(2.029)+(5.011), (I-746)+(2.029)+(5.012), (I-746)+(2.029)+(5.013), (I-746)+(2.029)+(5.014), (I-746)+(2.029)+(5.015), (I-746)+(2.029)+(5.016), (I-746)+(2.029)+(5.017), (I-746)+(2.029)+(5.018), (I-746)+(2.029)+(5.019), (I-746)+(2.029)+(5.020), (I-746)+(2.029)+(5.021), (I-746)+(2.029)+(5.022), (I-746)+(2.029)+(5.023), (I-746)+(2.029)+(6.001), (I-746)+(2.029)+(6.002), (I-746)+(2.029)+(6.003), (I-746)+(2.029)+(6.004), (I-746)+(2.029)+(7.001), (I-746)+(2.029)+(7.002), (I-746)+(2.029)+(7.003), (I-746)+(2.029)+(7.004), (I-746)+(2.029)+(7.005), (I-746)+(2.029)+(7.006), (I-746)+(2.029)+(9.001), (I-746)+(2.029)+(9.002), (I-746)+(2.029)+(9.003), (I-746)+(2.029)+(9.004), (I-746)+(2.029)+(9.005), (I-746)+(2.029)+(9.006), (I-746)+(2.029)+(9.007), (I-746)+(2.029)+(9.008), (I-746)+(2.029)+(9.009), (I-746)+(2.029)+(14.001), (I-746)+(2.029)+(14.002), (I-746)+(2.029)+(15.008), (I-746)+(2.029)+(15.011), (I-746)+(2.029)+(15.012), (I-746)+(2.029)+(15.016), (I-746)+(2.029)+(15.025), (I-746)+(2.029)+(15.027), (I-746)+(2.029)+(15.047), (I-746)+(2.029)+(15.063), (I-746)+(2.029)+(15.064), (I-746)+(2.029)+(16.001), (I-746)+(2.029)+(16.002), (I-746)+(2.029)+(16.003), (I-746)+(2.029)+(16.004), (I-746)+(2.029)+(16.005), (I-746)+(2.029)+(16.006), (I-746)+(2.029)+(16.007), (I-746)+(2.029)+(16.008), (I-746)+(2.029)+(17.001), (I-746)+(2.029)+(17.002), (I-746)+(2.029)+(17.003), (I-746)+(2.029)+(17.004), (I-746)+(2.029)+(17.005), (I-746)+(2.029)+(17.006), (I-746)+(2.029)+(17.007), (I-746)+(2.029)+(17.008), (I-746)+(2.029)+(17.009), (I-746)+(2.029)+(17.010), (I-746)+(2.029)+(17.011), (I-746)+(2.029)+(17.012), (I-746)+(2.029)+(18.001),

(I-746)+(2.030)+(3.001), (I-746)+(2.030)+(3.002), (I-746)+(2.030)+(3.003), (I-746)+(2.030)+(3.004), (I-746)+(2.030)+(3.005), (I-746)+(2.030)+(3.006), (I-746)+(2.030)+(3.007), (I-746)+(2.030)+(3.008), (I-746)+(2.030)+(3.009), (I-746)+(2.030)+(3.010), (I-746)+(2.030)+(3.011), (I-746)+(2.030)+(3.012), (I-746)+(2.030)+(3.013), (I-746)+(2.030)+(3.014), (I-746)+(2.030)+(3.015), (I-746)+(2.030)+(3.016), (I-746)+(2.030)+(3.017), (I-746)+(2.030)+(3.018), (I-746)+(2.030)+(3.019), (I-746)+(2.030)+(3.020), (I-746)+(2.030)+(3.021), (I-746)+(2.030)+(3.022), (I-746)+(2.030)+(3.023), (I-746)+(2.030)+(3.024), (I-746)+(2.030)+(3.025), (I-746)+(2.030)+(3.026), (I-746)+(2.030)+(3.027), (I-746)+(2.030)+(3.028), (I-746)+(2.030)+(3.029), (I-746)+(2.030)+(3.030), (I-746)+(2.030)+(3.031), (I-746)+(2.030)+(5.001), (I-746)+(2.030)+(5.002), (I-746)+(2.030)+(5.003), (I-746)+(2.030)+(5.004), (I-746)+(2.030)+(5.005), (I-746)+(2.030)+(5.006), (I-746)+(2.030)+(5.007), (I-746)+(2.030)+(5.008), (I-746)+(2.030)+(5.009), (I-746)+(2.030)+(5.010), (I-746)+(2.030)+(5.011), (I-746)+(2.030)+(5.012), (I-746)+(2.030)+(5.013), (I-746)+(2.030)+(5.014), (I-746)+(2.030)+(5.015), (I-746)+(2.030)+(5.016), (I-746)+(2.030)+(5.017), (I-746)+(2.030)+(5.018), (I-746)+(2.030)+(5.019), (I-746)+(2.030)+(5.020), (I-746)+(2.030)+(5.021), (I-746)+(2.030)+(5.022), (I-746)+(2.030)+(5.023), (I-746)+(2.030)+(6.001), (I-746)+(2.030)+(6.002), (I-746)+(2.030)+(6.003), (I-746)+(2.030)+(6.004), (I-746)+(2.030)+(7.001), (I-746)+(2.030)+(7.002), (I-746)+(2.030)+(7.003), (I-746)+(2.030)+(7.004), (I-746)+(2.030)+(7.005), (I-746)+(2.030)+(7.006), (I-746)+(2.030)+(9.001), (I-746)+(2.030)+(9.002), (I-746)+(2.030)+(9.003), (I-746)+(2.030)+(9.004), (I-746)+(2.030)+(9.005), (I-746)+(2.030)+(9.006), (I-746)+(2.030)+(9.007), (I-746)+(2.030)+(9.008), (I-746)+(2.030)+(9.009), (I-746)+(2.030)+(14.001), (I-746)+(2.030)+(14.002), (I-746)+(2.030)+(15.008), (I-746)+(2.030)+(15.011), (I-746)+(2.030)+(15.012), (I-746)+(2.030)+(15.016), (I-746)+(2.030)+(15.025), (I-746)+(2.030)+(15.027), (I-746)+(2.030)+(15.047), (I-746)+(2.030)+(15.063), (I-746)+(2.030)+(15.064), (I-746)+(2.030)+(16.001), (I-746)+(2.030)+(16.002), (I-746)+(2.030)+(16.003), (I-746)+(2.030)+(16.004), (I-746)+(2.030)+(16.005), (I-746)+(2.030)+(16.006), (I-746)+(2.030)+(16.007), (I-746)+(2.030)+(16.008), (I-746)+(2.030)+(17.001), (I-746)+(2.030)+(17.002), (I-746)+(2.030)+(17.003), (I-746)+(2.030)+(17.004), (I-746)+(2.030)+(17.005), (I-746)+(2.030)+(17.006), (I-746)+(2.030)+(17.007), (I-746)+(2.030)+(17.008), (I-746)+(2.030)+(17.009), (I-746)+(2.030)+(17.010), (I-746)+(2.030)+(17.011), (I-746)+(2.030)+(17.012), (I-746)+(2.030)+(18.001),

(I-746)+(2.031)+(3.001), (I-746)+(2.031)+(3.002), (I-746)+(2.031)+(3.003), (I-746)+(2.031)+(3.004), (I-746)+(2.031)+(3.005), (I-746)+(2.031)+(3.006), (I-746)+(2.031)+(3.007), (I-746)+(2.031)+(3.008), (I-746)+(2.031)+(3.009), (I-746)+(2.031)+(3.010), (I-746)+(2.031)+(3.011), (I-746)+(2.031)+(3.012), (I-746)+(2.031)+(3.013), (I-746)+(2.031)+(3.014), (I-746)+(2.031)+(3.015), (I-746)+(2.031)+(3.016), (I-746)+(2.031)+(3.017), (I-746)+(2.031)+(3.018), (I-746)+(2.031)+(3.019), (I-746)+(2.031)+(3.020), (I-746)+(2.031)+(3.021), (I-746)+(2.031)+(3.022), (I-746)+(2.031)+(3.023), (I-746)+(2.031)+(3.024), (I-746)+(2.031)+(3.025), (I-746)+(2.031)+(3.026), (I-746)+(2.031)+(3.027), (I-746)+(2.031)+(3.028), (I-746)+(2.031)+(3.029), (I-746)+(2.031)+(3.030), (I-746)+(2.031)+(3.031), (I-746)+(2.031)+(5.001), (I-746)+(2.031)+(5.002), (I-746)+(2.031)+(5.003), (I-746)+(2.031)+(5.004), (I-746)+(2.031)+(5.005), (I-746)+(2.031)+(5.006), (I-746)+(2.031)+(5.007), (I-746)+(2.031)+(5.008), (I-746)+(2.031)+(5.009), (I-746)+(2.031)+(5.010), (I-746)+(2.031)+(5.011), (I-746)+(2.031)+(5.012), (I-746)+(2.031)+(5.013), (I-746)+(2.031)+(5.014), (I-746)+(2.031)+(5.015), (I-746)+(2.031)+(5.016), (I-746)+(2.031)+(5.017), (I-746)+(2.031)+(5.018), (I-746)+(2.031)+(5.019), (I-746)+(2.031)+(5.020), (I-746)+(2.031)+(5.021), (I-746)+(2.031)+(5.022), (I-746)+(2.031)+(5.023), (I-746)+(2.031)+(6.001), (I-746)+(2.031)+(6.002), (I-746)+(2.031)+(6.003), (I-746)+(2.031)+(6.004), (I-746)+(2.031)+(7.001), (I-746)+(2.031)+(7.002), (I-746)+(2.031)+(7.003), (I-746)+(2.031)+(7.004), (I-746)+(2.031)+(7.005), (I-746)+(2.031)+(7.006), (I-746)+(2.031)+(9.001), (I-746)+(2.031)+(9.002), (I-746)+(2.031)+(9.003), (I-746)+(2.031)+(9.004), (I-746)+(2.031)+(9.005), (I-746)+(2.031)+(9.006), (I-746)+(2.031)+(9.007), (I-746)+(2.031)+(9.008), (I-746)+(2.031)+(9.009), (I-746)+(2.031)+(14.001), (I-746)+(2.031)+(14.002), (I-746)+(2.031)+(15.008), (I-746)+(2.031)+(15.011), (I-746)+(2.031)+(15.012), (I-746)+(2.031)+(15.016), (I-746)+(2.031)+(15.025), (I-746)+(2.031)+(15.027), (I-746)+(2.031)+(15.047), (I-746)+(2.031)+(15.063), (I-746)+(2.031)+(15.064), (I-746)+(2.031)+(16.001), (I-746)+(2.031)+(16.002), (I-746)+(2.031)+(16.003), (I-746)+(2.031)+(16.004), (I-746)+(2.031)+(16.005), (I-746)+(2.031)+(16.006), (I-746)+(2.031)+(16.007), (I-746)+(2.031)+(16.008), (I-746)+(2.031)+(17.001), (I-746)+(2.031)+(17.002), (I-746)+(2.031)+(17.003), (I-746)+(2.031)+(17.004), (I-746)+(2.031)+(17.005), (I-746)+(2.031)+(17.006), (I-746)+(2.031)+(17.007), (I-746)+(2.031)+(17.008), (I-746)+(2.031)+(17.009), (I-746)+(2.031)+(17.010), (I-746)+(2.031)+(17.011), (I-746)+(2.031)+(17.012), (I-746)+(2.031)+(18.001),

(I-746)+(2.032)+(3.001), (I-746)+(2.032)+(3.002), (I-746)+(2.032)+(3.003), (I-746)+(2.032)+(3.004), (I-746)+(2.032)+(3.005), (I-746)+(2.032)+(3.006), (I-746)+(2.032)+(3.007), (I-746)+(2.032)+(3.008), (I-746)+(2.032)+(3.009), (I-746)+(2.032)+(3.010), (I-746)+(2.032)+(3.011), (I-746)+(2.032)+(3.012), (I-746)+(2.032)+(3.013), (I-746)+(2.032)+(3.014), (I-746)+(2.032)+(3.015), (I-746)+(2.032)+(3.016), (I-746)+(2.032)+(3.017), (I-746)+(2.032)+(3.018), (I-746)+(2.032)+(3.019), (I-746)+(2.032)+(3.020), (I-746)+(2.032)+(3.021), (I-746)+(2.032)+(3.022), (I-746)+(2.032)+(3.023), (I-746)+(2.032)+(3.024), (I-746)+(2.032)+(3.025), (I-746)+(2.032)+(3.026), (I-746)+(2.032)+(3.027), (I-746)+(2.032)+(3.028), (I-746)+(2.032)+(3.029), (I-746)+(2.032)+(3.030), (I-746)+(2.032)+(3.031), (I-746)+(2.032)+(5.001), (I-746)+(2.032)+(5.002), (I-746)+(2.032)+(5.003), (I-746)+(2.032)+(5.004), (I-746)+(2.032)+(5.005), (I-746)+(2.032)+(5.006), (I-746)+(2.032)+(5.007), (I-746)+(2.032)+(5.008), (I-746)+(2.032)+(5.009), (I-746)+(2.032)+(5.010), (I-746)+(2.032)+(5.011), (I-746)+(2.032)+(5.012), (I-746)+(2.032)+(5.013), (I-746)+(2.032)+(5.014), (I-746)+(2.032)+(5.015), (I-746)+(2.032)+(5.016), (I-746)+(2.032)+(5.017), (I-746)+(2.032)+(5.018), (I-746)+(2.032)+(5.019), (I-746)+(2.032)+(5.020), (I-746)+(2.032)+(5.021), (I-746)+(2.032)+(5.022), (I-746)+(2.032)+(5.023), (I-746)+(2.032)+(6.001), (I-746)+(2.032)+(6.002), (I-746)+(2.032)+(6.003), (I-746)+(2.032)+(6.004), (I-746)+(2.032)+(7.001), (I-746)+(2.032)+(7.002), (I-746)+(2.032)+(7.003), (I-746)+(2.032)+(7.004), (I-746)+(2.032)+(7.005), (I-746)+(2.032)+(7.006), (I-746)+(2.032)+(9.001), (I-746)+(2.032)+(9.002), (I-746)+(2.032)+(9.003), (I-746)+(2.032)+(9.004), (I-746)+(2.032)+(9.005), (I-746)+(2.032)+(9.006), (I-746)+(2.032)+(9.007), (I-746)+(2.032)+(9.008), (I-746)+(2.032)+(9.009), (I-746)+(2.032)+(14.001), (I-746)+(2.032)+(14.002), (I-746)+(2.032)+(15.008), (I-746)+(2.032)+(15.011), (I-746)+(2.032)+(15.012), (I-746)+(2.032)+(15.016), (I-746)+(2.032)+(15.025), (I-746)+(2.032)+(15.027), (I-746)+(2.032)+(15.047), (I-746)+(2.032)+(15.063), (I-746)+(2.032)+(15.064), (I-746)+(2.032)+(16.001), (I-746)+(2.032)+(16.002), (I-746)+(2.032)+(16.003), (I-746)+(2.032)+(16.004), (I-746)+(2.032)+(16.005), (I-746)+(2.032)+(16.006), (I-746)+(2.032)+(16.007), (I-746)+(2.032)+(16.008), (I-746)+(2.032)+(17.001), (I-746)+(2.032)+(17.002), (I-746)+(2.032)+(17.003), (I-746)+(2.032)+(17.004), (I-746)+(2.032)+(17.005), (I-746)+(2.032)+(17.006), (I-746)+(2.032)+(17.007), (I-746)+(2.032)+(17.008), (I-746)+(2.032)+(17.009), (I-746)+(2.032)+(17.010), (I-746)+(2.032)+(17.011), (I-746)+(2.032)+(17.012), (I-746)+(2.032)+(18.001),

(I-746)+(2.033)+(3.001), (I-746)+(2.033)+(3.002), (I-746)+(2.033)+(3.003), (I-746)+(2.033)+(3.004), (I-746)+(2.033)+(3.005), (I-746)+(2.033)+(3.006), (I-746)+(2.033)+(3.007), (I-746)+(2.033)+(3.008), (I-746)+(2.033)+(3.009), (I-746)+(2.033)+(3.010), (I-746)+(2.033)+(3.011), (I-746)+(2.033)+(3.012), (I-746)+(2.033)+(3.013), (I-746)+(2.033)+(3.014), (I-746)+(2.033)+(3.015), (I-746)+(2.033)+(3.016), (I-746)+(2.033)+(3.017), (I-746)+(2.033)+(3.018), (I-746)+(2.033)+(3.019), (I-746)+(2.033)+(3.020), (I-746)+(2.033)+(3.021), (I-746)+(2.033)+(3.022), (I-746)+(2.033)+(3.023), (I-746)+(2.033)+(3.024), (I-746)+(2.033)+(3.025), (I-746)+(2.033)+(3.026), (I-746)+(2.033)+(3.027), (I-746)+(2.033)+(3.028), (I-746)+(2.033)+(3.029), (I-746)+(2.033)+(3.030), (I-746)+(2.033)+(3.031), (I-746)+(2.033)+(5.001), (I-746)+(2.033)+(5.002), (I-746)+(2.033)+(5.003), (I-746)+(2.033)+(5.004), (I-746)+(2.033)+(5.005), (I-746)+(2.033)+(5.006), (I-746)+(2.033)+(5.007), (I-746)+(2.033)+(5.008), (I-746)+(2.033)+(5.009), (I-746)+(2.033)+(5.010), (I-746)+(2.033)+(5.011), (I-746)+(2.033)+(5.012), (I-746)+(2.033)+(5.013), (I-746)+(2.033)+(5.014), (I-746)+(2.033)+(5.015), (I-746)+(2.033)+(5.016), (I-746)+(2.033)+(5.017), (I-746)+(2.033)+(5.018), (I-746)+(2.033)+(5.019), (I-746)+(2.033)+(5.020), (I-746)+(2.033)+(5.021), (I-746)+(2.033)+(5.022), (I-746)+(2.033)+(5.023), (I-746)+(2.033)+(6.001), (I-746)+(2.033)+(6.002), (I-746)+(2.033)+(6.003), (I-746)+(2.033)+(6.004), (I-746)+(2.033)+(7.001), (I-746)+(2.033)+(7.002), (I-746)+(2.033)+(7.003), (I-746)+(2.033)+(7.004), (I-746)+(2.033)+(7.005), (I-746)+(2.033)+(7.006), (I-746)+(2.033)+(9.001), (I-746)+(2.033)+(9.002), (I-746)+(2.033)+(9.003), (I-746)+(2.033)+(9.004), (I-746)+(2.033)+(9.005), (I-746)+(2.033)+(9.006), (I-746)+(2.033)+(9.007), (I-746)+(2.033)+(9.008), (I-746)+(2.033)+(9.009), (I-746)+(2.033)+(14.001), (I-746)+(2.033)+(14.002), (I-746)+(2.033)+(15.008), (I-746)+(2.033)+(15.011), (I-746)+(2.033)+(15.012), (I-746)+(2.033)+(15.016), (I-746)+(2.033)+(15.025), (I-746)+(2.033)+(15.027), (I-746)+(2.033)+(15.047), (I-746)+(2.033)+(15.063), (I-746)+(2.033)+(15.064), (I-746)+(2.033)+(16.001), (I-746)+(2.033)+(16.002), (I-746)+(2.033)+(16.003), (I-746)+(2.033)+(16.004), (I-746)+(2.033)+(16.005), (I-746)+(2.033)+(16.006), (I-746)+(2.033)+(16.007), (I-746)+(2.033)+(16.008), (I-746)+(2.033)+(17.001), (I-746)+(2.033)+(17.002), (I-746)+(2.033)+(17.003), (I-746)+(2.033)+(17.004), (I-746)+(2.033)+(17.005), (I-746)+(2.033)+(17.006), (I-746)+(2.033)+(17.007), (I-746)+(2.033)+(17.008), (I-746)+(2.033)+(17.009), (I-746)+(2.033)+(17.010), (I-746)+(2.033)+(17.011), (I-746)+(2.033)+(17.012), (I-746)+(2.033)+(18.001),

(I-746)+(2.034)+(3.001), (I-746)+(2.034)+(3.002), (I-746)+(2.034)+(3.003), (I-746)+(2.034)+(3.004), (I-746)+(2.034)+(3.005), (I-746)+(2.034)+(3.006), (I-746)+(2.034)+(3.007), (I-746)+(2.034)+(3.008), (I-746)+(2.034)+(3.009), (I-746)+(2.034)+(3.010), (I-746)+(2.034)+(3.011), (I-746)+(2.034)+(3.012), (I-746)+(2.034)+(3.013), (I-746)+(2.034)+(3.014), (I-746)+(2.034)+(3.015), (I-746)+(2.034)+(3.016), (I-746)+(2.034)+(3.017), (I-746)+(2.034)+(3.018), (I-746)+(2.034)+(3.019), (I-746)+(2.034)+(3.020), (I-746)+(2.034)+(3.021), (I-746)+(2.034)+(3.022), (I-746)+(2.034)+(3.023), (I-746)+(2.034)+(3.024), (I-746)+(2.034)+(3.025), (I-746)+(2.034)+(3.026), (I-746)+(2.034)+(3.027), (I-746)+(2.034)+(3.028), (I-746)+(2.034)+(3.029), (I-746)+(2.034)+(3.030), (I-746)+(2.034)+(3.031), (I-746)+(2.034)+(5.001), (I-746)+(2.034)+(5.002), (I-746)+(2.034)+(5.003), (I-746)+(2.034)+(5.004), (I-746)+(2.034)+(5.005), (I-746)+(2.034)+(5.006), (I-746)+(2.034)+(5.007), (I-746)+(2.034)+(5.008), (I-746)+(2.034)+(5.009), (I-746)+(2.034)+(5.010), (I-746)+(2.034)+(5.011), (I-746)+(2.034)+(5.012), (I-746)+(2.034)+(5.013), (I-746)+(2.034)+(5.014), (I-746)+(2.034)+(5.015), (I-746)+(2.034)+(5.016), (I-746)+(2.034)+(5.017), (I-746)+(2.034)+(5.018), (I-746)+(2.034)+(5.019), (I-746)+(2.034)+(5.020), (I-746)+(2.034)+(5.021), (I-746)+(2.034)+(5.022), (I-746)+(2.034)+(5.023), (I-746)+(2.034)+(6.001), (I-746)+(2.034)+(6.002), (I-746)+(2.034)+(6.003), (I-746)+(2.034)+(6.004), (I-746)+(2.034)+(7.001), (I-746)+(2.034)+(7.002), (I-746)+(2.034)+(7.003), (I-746)+(2.034)+(7.004), (I-746)+(2.034)+(7.005), (I-746)+(2.034)+(7.006), (I-746)+(2.034)+(9.001), (I-746)+(2.034)+(9.002), (I-746)+(2.034)+(9.003), (I-746)+(2.034)+(9.004), (I-746)+(2.034)+(9.005), (I-746)+(2.034)+(9.006), (I-746)+(2.034)+(9.007), (I-746)+(2.034)+(9.008), (I-746)+(2.034)+(9.009), (I-746)+(2.034)+(14.001), (I-746)+(2.034)+(14.002), (I-746)+(2.034)+(15.008), (I-746)+(2.034)+(15.011), (I-746)+(2.034)+(15.012), (I-746)+(2.034)+(15.016), (I-746)+(2.034)+(15.025), (I-746)+(2.034)+(15.027), (I-746)+(2.034)+(15.047), (I-746)+(2.034)+(15.063), (I-746)+(2.034)+(15.064), (I-746)+(2.034)+(16.001), (I-746)+(2.034)+(16.002), (I-746)+(2.034)+(16.003), (I-746)+(2.034)+(16.004), (I-746)+(2.034)+(16.005), (I-746)+(2.034)+(16.006), (I-746)+(2.034)+(16.007), (I-746)+(2.034)+(16.008), (I-746)+(2.034)+(17.001), (I-746)+(2.034)+(17.002), (I-746)+(2.034)+(17.003), (I-746)+(2.034)+(17.004), (I-746)+(2.034)+(17.005), (I-746)+(2.034)+(17.006), (I-746)+(2.034)+(17.007), (I-746)+(2.034)+(17.008), (I-746)+(2.034)+(17.009), (I-746)+(2.034)+(17.010), (I-746)+(2.034)+(17.011), (I-746)+(2.034)+(17.012), (I-746)+(2.034)+(18.001),

(I-746)+(2.035)+(3.001), (I-746)+(2.035)+(3.002), (I-746)+(2.035)+(3.003), (I-746)+(2.035)+(3.004), (I-746)+(2.035)+(3.005), (I-746)+(2.035)+(3.006), (I-746)+(2.035)+(3.007), (I-746)+(2.035)+(3.008), (I-746)+(2.035)+(3.009), (I-746)+(2.035)+(3.010), (I-746)+(2.035)+(3.011), (I-746)+(2.035)+(3.012), (I-746)+(2.035)+(3.013), (I-746)+(2.035)+(3.014), (I-746)+(2.035)+(3.015), (I-746)+(2.035)+(3.016), (I-746)+(2.035)+(3.017), (I-746)+(2.035)+(3.018), (I-746)+(2.035)+(3.019), (I-746)+(2.035)+(3.020), (I-746)+(2.035)+(3.021), (I-746)+(2.035)+(3.022), (I-746)+(2.035)+(3.023), (I-746)+(2.035)+(3.024), (I-746)+(2.035)+(3.025), (I-746)+(2.035)+(3.026), (I-746)+(2.035)+(3.027), (I-746)+(2.035)+(3.028), (I-746)+(2.035)+(3.029), (I-746)+(2.035)+(3.030), (I-746)+(2.035)+(3.031), (I-746)+(2.035)+(5.001), (I-746)+(2.035)+(5.002), (I-746)+(2.035)+(5.003), (I-746)+(2.035)+(5.004), (I-746)+(2.035)+(5.005), (I-746)+(2.035)+(5.006), (I-746)+(2.035)+(5.007), (I-746)+(2.035)+(5.008), (I-746)+(2.035)+(5.009), (I-746)+(2.035)+(5.010), (I-746)+(2.035)+(5.011), (I-746)+(2.035)+(5.012), (I-746)+(2.035)+(5.013), (I-746)+(2.035)+(5.014), (I-746)+(2.035)+(5.015), (I-746)+(2.035)+(5.016), (I-746)+(2.035)+(5.017), (I-746)+(2.035)+(5.018), (I-746)+(2.035)+(5.019), (I-746)+(2.035)+(5.020), (I-746)+(2.035)+(5.021), (I-746)+(2.035)+(5.022), (I-746)+(2.035)+(5.023), (I-746)+(2.035)+(6.001), (I-746)+(2.035)+(6.002), (I-746)+(2.035)+(6.003), (I-746)+(2.035)+(6.004), (I-746)+(2.035)+(7.001), (I-746)+(2.035)+(7.002), (I-746)+(2.035)+(7.003), (I-746)+(2.035)+(7.004), (I-746)+(2.035)+(7.005), (I-746)+(2.035)+(7.006), (I-746)+(2.035)+(9.001), (I-746)+(2.035)+(9.002), (I-746)+(2.035)+(9.003), (I-746)+(2.035)+(9.004), (I-746)+(2.035)+(9.005), (I-746)+(2.035)+(9.006), (I-746)+(2.035)+(9.007), (I-746)+(2.035)+(9.008), (I-746)+(2.035)+(9.009), (I-746)+(2.035)+(14.001), (I-746)+(2.035)+(14.002), (I-746)+(2.035)+(15.008), (I-746)+(2.035)+(15.011), (I-746)+(2.035)+(15.012), (I-746)+(2.035)+(15.016), (I-746)+(2.035)+(15.025), (I-746)+(2.035)+(15.027), (I-746)+(2.035)+(15.047), (I-746)+(2.035)+(15.063), (I-746)+(2.035)+(15.064), (I-746)+(2.035)+(16.001), (I-746)+(2.035)+(16.002), (I-746)+(2.035)+(16.003), (I-746)+(2.035)+(16.004), (I-746)+(2.035)+(16.005), (I-746)+(2.035)+(16.006), (I-746)+(2.035)+(16.007), (I-746)+(2.035)+(16.008), (I-746)+(2.035)+(17.001), (I-746)+(2.035)+(17.002), (I-746)+(2.035)+(17.003), (I-746)+(2.035)+(17.004), (I-746)+(2.035)+(17.005), (I-746)+(2.035)+(17.006), (I-746)+(2.035)+(17.007), (I-746)+(2.035)+(17.008), (I-746)+(2.035)+(17.009), (I-746)+(2.035)+(17.010), (I-746)+(2.035)+(17.011), (I-746)+(2.035)+(17.012), (I-746)+(2.035)+(18.001),

(I-746)+(2.036)+(3.001), (I-746)+(2.036)+(3.002), (I-746)+(2.036)+(3.003), (I-746)+(2.036)+(3.004), (I-746)+(2.036)+(3.005), (I-746)+(2.036)+(3.006), (I-746)+(2.036)+(3.007), (I-746)+(2.036)+(3.008), (I-746)+(2.036)+(3.009), (I-746)+(2.036)+(3.010), (I-746)+(2.036)+(3.011), (I-746)+(2.036)+(3.012), (I-746)+(2.036)+(3.013), (I-746)+(2.036)+(3.014), (I-746)+(2.036)+(3.015), (I-746)+(2.036)+(3.016), (I-746)+(2.036)+(3.017), (I-746)+(2.036)+(3.018), (I-746)+(2.036)+(3.019), (I-746)+(2.036)+(3.020), (I-746)+(2.036)+(3.021), (I-746)+(2.036)+(3.022), (I-746)+(2.036)+(3.023), (I-746)+(2.036)+(3.024), (I-746)+(2.036)+(3.025), (I-746)+(2.036)+(3.026), (I-746)+(2.036)+(3.027), (I-746)+(2.036)+(3.028), (I-746)+(2.036)+(3.029), (I-746)+(2.036)+(3.030), (I-746)+(2.036)+(3.031), (I-746)+(2.036)+(5.001), (I-746)+(2.036)+(5.002), (I-746)+(2.036)+(5.003), (I-746)+(2.036)+(5.004), (I-746)+(2.036)+(5.005), (I-746)+(2.036)+(5.006), (I-746)+(2.036)+(5.007), (I-746)+(2.036)+(5.008), (I-746)+(2.036)+(5.009), (I-746)+(2.036)+(5.010), (I-746)+(2.036)+(5.011), (I-746)+(2.036)+(5.012), (I-746)+(2.036)+(5.013), (I-746)+(2.036)+(5.014), (I-746)+(2.036)+(5.015), (I-746)+(2.036)+(5.016), (I-746)+(2.036)+(5.017), (I-746)+(2.036)+(5.018), (I-746)+(2.036)+(5.019), (I-746)+(2.036)+(5.020), (I-746)+(2.036)+(5.021), (I-746)+(2.036)+(5.022), (I-746)+(2.036)+(5.023), (I-746)+(2.036)+(6.001), (I-746)+(2.036)+(6.002), (I-746)+(2.036)+(6.003), (I-746)+(2.036)+(6.004), (I-746)+(2.036)+(7.001), (I-746)+(2.036)+(7.002), (I-746)+(2.036)+(7.003), (I-746)+(2.036)+(7.004), (I-746)+(2.036)+(7.005), (I-746)+(2.036)+(7.006), (I-746)+(2.036)+(9.001), (I-746)+(2.036)+(9.002), (I-746)+(2.036)+(9.003), (I-746)+(2.036)+(9.004), (I-746)+(2.036)+(9.005), (I-746)+(2.036)+(9.006), (I-746)+(2.036)+(9.007), (I-746)+(2.036)+(9.008), (I-746)+(2.036)+(9.009), (I-746)+(2.036)+(14.001), (I-746)+(2.036)+(14.002), (I-746)+(2.036)+(15.008), (I-746)+(2.036)+(15.011), (I-746)+(2.036)+(15.012), (I-746)+(2.036)+(15.016), (I-746)+(2.036)+(15.025), (I-746)+(2.036)+(15.027), (I-746)+(2.036)+(15.047), (I-746)+(2.036)+(15.063), (I-746)+(2.036)+(15.064), (I-746)+(2.036)+(16.001), (I-746)+(2.036)+(16.002), (I-746)+(2.036)+(16.003), (I-746)+(2.036)+(16.004), (I-746)+(2.036)+(16.005), (I-746)+(2.036)+(16.006), (I-746)+(2.036)+(16.007), (I-746)+(2.036)+(16.008), (I-746)+(2.036)+(17.001), (I-746)+(2.036)+(17.002), (I-746)+(2.036)+(17.003), (I-746)+(2.036)+(17.004), (I-746)+(2.036)+(17.005), (I-746)+(2.036)+(17.006), (I-746)+(2.036)+(17.007), (I-746)+(2.036)+(17.008), (I-746)+(2.036)+(17.009), (I-746)+(2.036)+(17.010), (I-746)+(2.036)+(17.011), (I-746)+(2.036)+(17.012), (I-746)+(2.036)+(18.001),

(I-746)+(2.037)+(3.001), (I-746)+(2.037)+(3.002), (I-746)+(2.037)+(3.003), (I-746)+(2.037)+(3.004), (I-746)+(2.037)+(3.005), (I-746)+(2.037)+(3.006), (I-746)+(2.037)+(3.007), (I-746)+(2.037)+(3.008), (I-746)+(2.037)+(3.009), (I-746)+(2.037)+(3.010), (I-746)+(2.037)+(3.011), (I-746)+(2.037)+(3.012), (I-746)+(2.037)+(3.013), (I-746)+(2.037)+(3.014), (I-746)+(2.037)+(3.015), (I-746)+(2.037)+(3.016), (I-746)+(2.037)+(3.017), (I-746)+(2.037)+(3.018), (I-746)+(2.037)+(3.019), (I-746)+(2.037)+(3.020), (I-746)+(2.037)+(3.021), (I-746)+(2.037)+(3.022), (I-746)+(2.037)+(3.023), (I-746)+(2.037)+(3.024), (I-746)+(2.037)+(3.025), (I-746)+(2.037)+(3.026), (I-746)+(2.037)+(3.027), (I-746)+(2.037)+(3.028), (I-746)+(2.037)+(3.029), (I-746)+(2.037)+(3.030), (I-746)+(2.037)+(3.031), (I-746)+(2.037)+(5.001), (I-746)+(2.037)+(5.002), (I-746)+(2.037)+(5.003), (I-746)+(2.037)+(5.004), (I-746)+(2.037)+(5.005), (I-746)+(2.037)+(5.006), (I-746)+(2.037)+(5.007), (I-746)+(2.037)+(5.008), (I-746)+(2.037)+(5.009), (I-746)+(2.037)+(5.010), (I-746)+(2.037)+(5.011), (I-746)+(2.037)+(5.012), (I-746)+(2.037)+(5.013), (I-746)+(2.037)+(5.014), (I-746)+(2.037)+(5.015), (I-746)+(2.037)+(5.016), (I-746)+(2.037)+(5.017), (I-746)+(2.037)+(5.018), (I-746)+(2.037)+(5.019), (I-746)+(2.037)+(5.020), (I-746)+(2.037)+(5.021), (I-746)+(2.037)+(5.022), (I-746)+(2.037)+(5.023), (I-746)+(2.037)+(6.001), (I-746)+(2.037)+(6.002), (I-746)+(2.037)+(6.003), (I-746)+(2.037)+(6.004), (I-746)+(2.037)+(7.001), (I-746)+(2.037)+(7.002), (I-746)+(2.037)+(7.003), (I-746)+(2.037)+(7.004), (I-746)+(2.037)+(7.005), (I-746)+(2.037)+(7.006), (I-746)+(2.037)+(9.001), (I-746)+(2.037)+(9.002), (I-746)+(2.037)+(9.003), (I-746)+(2.037)+(9.004), (I-746)+(2.037)+(9.005), (I-746)+(2.037)+(9.006), (I-746)+(2.037)+(9.007), (I-746)+(2.037)+(9.008), (I-746)+(2.037)+(9.009), (I-746)+(2.037)+(14.001), (I-746)+(2.037)+(14.002), (I-746)+(2.037)+(15.008), (I-746)+(2.037)+(15.011), (I-746)+(2.037)+(15.012), (I-746)+(2.037)+(15.016), (I-746)+(2.037)+(15.025), (I-746)+(2.037)+(15.027), (I-746)+(2.037)+(15.047), (I-746)+(2.037)+(15.063), (I-746)+(2.037)+(15.064), (I-746)+(2.037)+(16.001), (I-746)+(2.037)+(16.002), (I-746)+(2.037)+(16.003), (I-746)+(2.037)+(16.004), (I-746)+(2.037)+(16.005), (I-746)+(2.037)+(16.006), (I-746)+(2.037)+(16.007), (I-746)+(2.037)+(16.008), (I-746)+(2.037)+(17.001), (I-746)+(2.037)+(17.002), (I-746)+(2.037)+(17.003), (I-746)+(2.037)+(17.004), (I-746)+(2.037)+(17.005), (I-746)+(2.037)+(17.006), (I-746)+(2.037)+(17.007), (I-746)+(2.037)+(17.008), (I-746)+(2.037)+(17.009), (I-746)+(2.037)+(17.010), (I-746)+(2.037)+(17.011), (I-746)+(2.037)+(17.012), (I-746)+(2.037)+(18.001),

(I-746)+(2.038)+(3.001), (I-746)+(2.038)+(3.002), (I-746)+(2.038)+(3.003), (I-746)+(2.038)+(3.004), (I-746)+(2.038)+(3.005), (I-746)+(2.038)+(3.006), (I-746)+(2.038)+(3.007), (I-746)+(2.038)+(3.008), (I-746)+(2.038)+(3.009), (I-746)+(2.038)+(3.010), (I-746)+(2.038)+(3.011), (I-746)+(2.038)+(3.012), (I-746)+(2.038)+(3.013), (I-746)+(2.038)+(3.014), (I-746)+(2.038)+(3.015), (I-746)+(2.038)+(3.016), (I-746)+(2.038)+(3.017), (I-746)+(2.038)+(3.018), (I-746)+(2.038)+(3.019), (I-746)+(2.038)+(3.020), (I-746)+(2.038)+(3.021), (I-746)+(2.038)+(3.022), (I-746)+(2.038)+(3.023), (I-746)+(2.038)+(3.024), (I-746)+(2.038)+(3.025), (I-746)+(2.038)+(3.026), (I-746)+(2.038)+(3.027), (I-746)+(2.038)+(3.028), (I-746)+(2.038)+(3.029), (I-746)+(2.038)+(3.030), (I-746)+(2.038)+(3.031), (I-746)+(2.038)+(5.001), (I-746)+(2.038)+(5.002), (I-746)+(2.038)+(5.003), (I-746)+(2.038)+(5.004), (I-746)+(2.038)+(5.005), (I-746)+(2.038)+(5.006), (I-746)+(2.038)+(5.007), (I-746)+(2.038)+(5.008), (I-746)+(2.038)+(5.009), (I-746)+(2.038)+(5.010), (I-746)+(2.038)+(5.011), (I-746)+(2.038)+(5.012), (I-746)+(2.038)+(5.013), (I-746)+(2.038)+(5.014), (I-746)+(2.038)+(5.015), (I-746)+(2.038)+(5.016), (I-746)+(2.038)+(5.017), (I-746)+(2.038)+(5.018), (I-746)+(2.038)+(5.019), (I-746)+(2.038)+(5.020), (I-746)+(2.038)+(5.021), (I-746)+(2.038)+(5.022), (I-746)+(2.038)+(5.023), (I-746)+(2.038)+(6.001), (I-746)+(2.038)+(6.002), (I-746)+(2.038)+(6.003), (I-746)+(2.038)+(6.004), (I-746)+(2.038)+(7.001), (I-746)+(2.038)+(7.002), (I-746)+(2.038)+(7.003), (I-746)+(2.038)+(7.004), (I-746)+(2.038)+(7.005), (I-746)+(2.038)+(7.006), (I-746)+(2.038)+(9.001), (I-746)+(2.038)+(9.002), (I-746)+(2.038)+(9.003), (I-746)+(2.038)+(9.004), (I-746)+(2.038)+(9.005), (I-746)+(2.038)+(9.006), (I-746)+(2.038)+(9.007), (I-746)+(2.038)+(9.008), (I-746)+(2.038)+(9.009), (I-746)+(2.038)+(14.001), (I-746)+(2.038)+(14.002), (I-746)+(2.038)+(15.008), (I-746)+(2.038)+(15.011), (I-746)+(2.038)+(15.012), (I-746)+(2.038)+(15.016), (I-746)+(2.038)+(15.025), (I-746)+(2.038)+(15.027), (I-746)+(2.038)+(15.047), (I-746)+(2.038)+(15.063), (I-746)+(2.038)+(15.064), (I-746)+(2.038)+(16.001), (I-746)+(2.038)+(16.002), (I-746)+(2.038)+(16.003), (I-746)+(2.038)+(16.004), (I-746)+(2.038)+(16.005), (I-746)+(2.038)+(16.006), (I-746)+(2.038)+(16.007), (I-746)+(2.038)+(16.008), (I-746)+(2.038)+(17.001), (I-746)+(2.038)+(17.002), (I-746)+(2.038)+(17.003), (I-746)+(2.038)+(17.004), (I-746)+(2.038)+(17.005), (I-746)+(2.038)+(17.006), (I-746)+(2.038)+(17.007), (I-746)+(2.038)+(17.008), (I-746)+(2.038)+(17.009), (I-746)+(2.038)+(17.010), (I-746)+(2.038)+(17.011), (I-746)+(2.038)+(17.012), (I-746)+(2.038)+(18.001),

(I-746)+(2.039)+(3.001), (I-746)+(2.039)+(3.002), (I-746)+(2.039)+(3.003), (I-746)+(2.039)+(3.004), (I-746)+(2.039)+(3.005), (I-746)+(2.039)+(3.006), (I-746)+(2.039)+(3.007), (I-746)+(2.039)+(3.008), (I-746)+(2.039)+(3.009), (I-746)+(2.039)+(3.010), (I-746)+(2.039)+(3.011), (I-746)+(2.039)+(3.012), (I-746)+(2.039)+(3.013), (I-746)+(2.039)+(3.014), (I-746)+(2.039)+(3.015), (I-746)+(2.039)+(3.016), (I-746)+(2.039)+(3.017), (I-746)+(2.039)+(3.018), (I-746)+(2.039)+(3.019), (I-746)+(2.039)+(3.020), (I-746)+(2.039)+(3.021), (I-746)+(2.039)+(3.022), (I-746)+(2.039)+(3.023), (I-746)+(2.039)+(3.024), (I-746)+(2.039)+(3.025), (I-746)+(2.039)+(3.026), (I-746)+(2.039)+(3.027), (I-746)+(2.039)+(3.028), (I-746)+(2.039)+(3.029), (I-746)+(2.039)+(3.030), (I-746)+(2.039)+(3.031), (I-746)+(2.039)+(5.001), (I-746)+(2.039)+(5.002), (I-746)+(2.039)+(5.003), (I-746)+(2.039)+(5.004), (I-746)+(2.039)+(5.005), (I-746)+(2.039)+(5.006), (I-746)+(2.039)+(5.007), (I-746)+(2.039)+(5.008), (I-746)+(2.039)+(5.009), (I-746)+(2.039)+(5.010), (I-746)+(2.039)+(5.011), (I-746)+(2.039)+(5.012), (I-746)+(2.039)+(5.013), (I-746)+(2.039)+(5.014), (I-746)+(2.039)+(5.015), (I-746)+(2.039)+(5.016), (I-746)+(2.039)+(5.017), (I-746)+(2.039)+(5.018), (I-746)+(2.039)+(5.019), (I-746)+(2.039)+(5.020), (I-746)+(2.039)+(5.021), (I-746)+(2.039)+(5.022), (I-746)+(2.039)+(5.023), (I-746)+(2.039)+(6.001), (I-746)+(2.039)+(6.002), (I-746)+(2.039)+(6.003), (I-746)+(2.039)+(6.004), (I-746)+(2.039)+(7.001), (I-746)+(2.039)+(7.002), (I-746)+(2.039)+(7.003), (I-746)+(2.039)+(7.004), (I-746)+(2.039)+(7.005), (I-746)+(2.039)+(7.006), (I-746)+(2.039)+(9.001), (I-746)+(2.039)+(9.002), (I-746)+(2.039)+(9.003), (I-746)+(2.039)+(9.004), (I-746)+(2.039)+(9.005), (I-746)+(2.039)+(9.006), (I-746)+(2.039)+(9.007), (I-746)+(2.039)+(9.008), (I-746)+(2.039)+(9.009), (I-746)+(2.039)+(14.001), (I-746)+(2.039)+(14.002), (I-746)+(2.039)+(15.008), (I-746)+(2.039)+(15.011), (I-746)+(2.039)+(15.012), (I-746)+(2.039)+(15.016), (I-746)+(2.039)+(15.025), (I-746)+(2.039)+(15.027), (I-746)+(2.039)+(15.047), (I-746)+(2.039)+(15.063), (I-746)+(2.039)+(15.064), (I-746)+(2.039)+(16.001), (I-746)+(2.039)+(16.002), (I-746)+(2.039)+(16.003), (I-746)+(2.039)+(16.004), (I-746)+(2.039)+(16.005), (I-746)+(2.039)+(16.006), (I-746)+(2.039)+(16.007), (I-746)+(2.039)+(16.008), (I-746)+(2.039)+(17.001), (I-746)+(2.039)+(17.002), (I-746)+(2.039)+(17.003), (I-746)+(2.039)+(17.004), (I-746)+(2.039)+(17.005), (I-746)+(2.039)+(17.006), (I-746)+(2.039)+(17.007), (I-746)+(2.039)+(17.008), (I-746)+(2.039)+(17.009), (I-746)+(2.039)+(17.010), (I-746)+(2.039)+(17.011), (I-746)+(2.039)+(17.012), (I-746)+(2.039)+(18.001),

(I-746)+(2.040)+(3.001), (I-746)+(2.040)+(3.002), (I-746)+(2.040)+(3.003), (I-746)+(2.040)+(3.004), (I-746)+(2.040)+(3.005), (I-746)+(2.040)+(3.006), (I-746)+(2.040)+(3.007), (I-746)+(2.040)+(3.008), (I-746)+(2.040)+(3.009), (I-746)+(2.040)+(3.010), (I-746)+(2.040)+(3.011), (I-746)+(2.040)+(3.012), (I-746)+(2.040)+(3.013), (I-746)+(2.040)+(3.014), (I-746)+(2.040)+(3.015), (I-746)+(2.040)+(3.016), (I-746)+(2.040)+(3.017), (I-746)+(2.040)+(3.018), (I-746)+(2.040)+(3.019), (I-746)+(2.040)+(3.020), (I-746)+(2.040)+(3.021), (I-746)+(2.040)+(3.022), (I-746)+(2.040)+(3.023), (I-746)+(2.040)+(3.024), (I-746)+(2.040)+(3.025), (I-746)+(2.040)+(3.026), (I-746)+(2.040)+(3.027), (I-746)+(2.040)+(3.028), (I-746)+(2.040)+(3.029), (I-746)+(2.040)+(3.030), (I-746)+(2.040)+(3.031), (I-746)+(2.040)+(5.001), (I-746)+(2.040)+(5.002), (I-746)+(2.040)+(5.003), (I-746)+(2.040)+(5.004), (I-746)+(2.040)+(5.005), (I-746)+(2.040)+(5.006), (I-746)+(2.040)+(5.007), (I-746)+(2.040)+(5.008), (I-746)+(2.040)+(5.009), (I-746)+(2.040)+(5.010), (I-746)+(2.040)+(5.011), (I-746)+(2.040)+(5.012), (I-746)+(2.040)+(5.013), (I-746)+(2.040)+(5.014), (I-746)+(2.040)+(5.015), (I-746)+(2.040)+(5.016), (I-746)+(2.040)+(5.017), (I-746)+(2.040)+(5.018), (I-746)+(2.040)+(5.019), (I-746)+(2.040)+(5.020), (I-746)+(2.040)+(5.021), (I-746)+(2.040)+(5.022), (I-746)+(2.040)+(5.023), (I-746)+(2.040)+(6.001), (I-746)+(2.040)+(6.002), (I-746)+(2.040)+(6.003), (I-746)+(2.040)+(6.004), (I-746)+(2.040)+(7.001), (I-746)+(2.040)+(7.002), (I-746)+(2.040)+(7.003), (I-746)+(2.040)+(7.004), (I-746)+(2.040)+(7.005), (I-746)+(2.040)+(7.006), (I-746)+(2.040)+(9.001), (I-746)+(2.040)+(9.002), (I-746)+(2.040)+(9.003), (I-746)+(2.040)+(9.004), (I-746)+(2.040)+(9.005), (I-746)+(2.040)+(9.006), (I-746)+(2.040)+(9.007), (I-746)+(2.040)+(9.008), (I-746)+(2.040)+(9.009), (I-746)+(2.040)+(14.001), (I-746)+(2.040)+(14.002), (I-746)+(2.040)+(15.008), (I-746)+(2.040)+(15.011), (I-746)+(2.040)+(15.012), (I-746)+(2.040)+(15.016), (I-746)+(2.040)+(15.025), (I-746)+(2.040)+(15.027), (I-746)+(2.040)+(15.047), (I-746)+(2.040)+(15.063), (I-746)+(2.040)+(15.064), (I-746)+(2.040)+(16.001), (I-746)+(2.040)+(16.002), (I-746)+(2.040)+(16.003), (I-746)+(2.040)+(16.004), (I-746)+(2.040)+(16.005), (I-746)+(2.040)+(16.006), (I-746)+(2.040)+(16.007), (I-746)+(2.040)+(16.008), (I-746)+(2.040)+(17.001), (I-746)+(2.040)+(17.002), (I-746)+(2.040)+(17.003), (I-746)+(2.040)+(17.004), (I-746)+(2.040)+(17.005), (I-746)+(2.040)+(17.006), (I-746)+(2.040)+(17.007), (I-746)+(2.040)+(17.008), (I-746)+(2.040)+(17.009), (I-746)+(2.040)+(17.010), (I-746)+(2.040)+(17.011), (I-746)+(2.040)+(17.012), (I-746)+(2.040)+(18.001),

(I-746)+(2.041)+(3.001), (I-746)+(2.041)+(3.002), (I-746)+(2.041)+(3.003), (I-746)+(2.041)+(3.004), (I-746)+(2.041)+(3.005), (I-746)+(2.041)+(3.006), (I-746)+(2.041)+(3.007), (I-746)+(2.041)+(3.008), (I-746)+(2.041)+(3.009), (I-746)+(2.041)+(3.010), (I-746)+(2.041)+(3.011), (I-746)+(2.041)+(3.012), (I-746)+(2.041)+(3.013), (I-746)+(2.041)+(3.014), (I-746)+(2.041)+(3.015), (I-746)+(2.041)+(3.016), (I-746)+(2.041)+(3.017), (I-746)+(2.041)+(3.018), (I-746)+(2.041)+(3.019), (I-746)+(2.041)+(3.020), (I-746)+(2.041)+(3.021), (I-746)+(2.041)+(3.022), (I-746)+(2.041)+(3.023), (I-746)+(2.041)+(3.024), (I-746)+(2.041)+(3.025), (I-746)+(2.041)+(3.026), (I-746)+(2.041)+(3.027), (I-746)+(2.041)+(3.028), (I-746)+(2.041)+(3.029), (I-746)+(2.041)+(3.030), (I-746)+(2.041)+(3.031), (I-746)+(2.041)+(5.001), (I-746)+(2.041)+(5.002), (I-746)+(2.041)+(5.003), (I-746)+(2.041)+(5.004), (I-746)+(2.041)+(5.005), (I-746)+(2.041)+(5.006), (I-746)+(2.041)+(5.007), (I-746)+(2.041)+(5.008), (I-746)+(2.041)+(5.009), (I-746)+(2.041)+(5.010), (I-746)+(2.041)+(5.011), (I-746)+(2.041)+(5.012), (I-746)+(2.041)+(5.013), (I-746)+(2.041)+(5.014), (I-746)+(2.041)+(5.015), (I-746)+(2.041)+(5.016), (I-746)+(2.041)+(5.017), (I-746)+(2.041)+(5.018), (I-746)+(2.041)+(5.019), (I-746)+(2.041)+(5.020), (I-746)+(2.041)+(5.021), (I-746)+(2.041)+(5.022), (I-746)+(2.041)+(5.023), (I-746)+(2.041)+(6.001), (I-746)+(2.041)+(6.002), (I-746)+(2.041)+(6.003), (I-746)+(2.041)+(6.004), (I-746)+(2.041)+(7.001), (I-746)+(2.041)+(7.002), (I-746)+(2.041)+(7.003), (I-746)+(2.041)+(7.004), (I-746)+(2.041)+(7.005), (I-746)+(2.041)+(7.006), (I-746)+(2.041)+(9.001), (I-746)+(2.041)+(9.002), (I-746)+(2.041)+(9.003), (I-746)+(2.041)+(9.004), (I-746)+(2.041)+(9.005), (I-746)+(2.041)+(9.006), (I-746)+(2.041)+(9.007), (I-746)+(2.041)+(9.008), (I-746)+(2.041)+(9.009), (I-746)+(2.041)+(14.001), (I-746)+(2.041)+(14.002), (I-746)+(2.041)+(15.008), (I-746)+(2.041)+(15.011), (I-746)+(2.041)+(15.012), (I-746)+(2.041)+(15.016), (I-746)+(2.041)+(15.025), (I-746)+(2.041)+(15.027), (I-746)+(2.041)+(15.047), (I-746)+(2.041)+(15.063), (I-746)+(2.041)+(15.064), (I-746)+(2.041)+(16.001), (I-746)+(2.041)+(16.002), (I-746)+(2.041)+(16.003), (I-746)+(2.041)+(16.004), (I-746)+(2.041)+(16.005), (I-746)+(2.041)+(16.006), (I-746)+(2.041)+(16.007), (I-746)+(2.041)+(16.008), (I-746)+(2.041)+(17.001), (I-746)+(2.041)+(17.002), (I-746)+(2.041)+(17.003), (I-746)+(2.041)+(17.004), (I-746)+(2.041)+(17.005), (I-746)+(2.041)+(17.006), (I-746)+(2.041)+(17.007), (I-746)+(2.041)+(17.008), (I-746)+(2.041)+(17.009), (I-746)+(2.041)+(17.010), (I-746)+(2.041)+(17.011), (I-746)+(2.041)+(17.012), (I-746)+(2.041)+(18.001),

(I-746)+(2.042)+(3.001), (I-746)+(2.042)+(3.002), (I-746)+(2.042)+(3.003), (I-746)+(2.042)+(3.004), (I-746)+(2.042)+(3.005), (I-746)+(2.042)+(3.006), (I-746)+(2.042)+(3.007), (I-746)+(2.042)+(3.008), (I-746)+(2.042)+(3.009), (I-746)+(2.042)+(3.010), (I-746)+(2.042)+(3.011), (I-746)+(2.042)+(3.012), (I-746)+(2.042)+(3.013), (I-746)+(2.042)+(3.014), (I-746)+(2.042)+(3.015), (I-746)+(2.042)+(3.016), (I-746)+(2.042)+(3.017), (I-746)+(2.042)+(3.018), (I-746)+(2.042)+(3.019), (I-746)+(2.042)+(3.020), (I-746)+(2.042)+(3.021), (I-746)+(2.042)+(3.022), (I-746)+(2.042)+(3.023), (I-746)+(2.042)+(3.024), (I-746)+(2.042)+(3.025), (I-746)+(2.042)+(3.026), (I-746)+(2.042)+(3.027), (I-746)+(2.042)+(3.028), (I-746)+(2.042)+(3.029), (I-746)+(2.042)+(3.030), (I-746)+(2.042)+(3.031), (I-746)+(2.042)+(5.001), (I-746)+(2.042)+(5.002), (I-746)+(2.042)+(5.003), (I-746)+(2.042)+(5.004), (I-746)+(2.042)+(5.005), (I-746)+(2.042)+(5.006), (I-746)+(2.042)+(5.007), (I-746)+(2.042)+(5.008), (I-746)+(2.042)+(5.009), (I-746)+(2.042)+(5.010), (I-746)+(2.042)+(5.011), (I-746)+(2.042)+(5.012), (I-746)+(2.042)+(5.013), (I-746)+(2.042)+(5.014), (I-746)+(2.042)+(5.015), (I-746)+(2.042)+(5.016), (I-746)+(2.042)+(5.017), (I-746)+(2.042)+(5.018), (I-746)+(2.042)+(5.019), (I-746)+(2.042)+(5.020), (I-746)+(2.042)+(5.021), (I-746)+(2.042)+(5.022), (I-746)+(2.042)+(5.023), (I-746)+(2.042)+(6.001), (I-746)+(2.042)+(6.002), (I-746)+(2.042)+(6.003), (I-746)+(2.042)+(6.004), (I-746)+(2.042)+(7.001), (I-746)+(2.042)+(7.002), (I-746)+(2.042)+(7.003), (I-746)+(2.042)+(7.004), (I-746)+(2.042)+(7.005), (I-746)+(2.042)+(7.006), (I-746)+(2.042)+(9.001), (I-746)+(2.042)+(9.002), (I-746)+(2.042)+(9.003), (I-746)+(2.042)+(9.004), (I-746)+(2.042)+(9.005), (I-746)+(2.042)+(9.006), (I-746)+(2.042)+(9.007), (I-746)+(2.042)+(9.008), (I-746)+(2.042)+(9.009), (I-746)+(2.042)+(14.001), (I-746)+(2.042)+(14.002), (I-746)+(2.042)+(15.008), (I-746)+(2.042)+(15.011), (I-746)+(2.042)+(15.012), (I-746)+(2.042)+(15.016), (I-746)+(2.042)+(15.025), (I-746)+(2.042)+(15.027), (I-746)+(2.042)+(15.047), (I-746)+(2.042)+(15.063), (I-746)+(2.042)+(15.064), (I-746)+(2.042)+(16.001), (I-746)+(2.042)+(16.002), (I-746)+(2.042)+(16.003), (I-746)+(2.042)+(16.004), (I-746)+(2.042)+(16.005), (I-746)+(2.042)+(16.006), (I-746)+(2.042)+(16.007), (I-746)+(2.042)+(16.008), (I-746)+(2.042)+(17.001), (I-746)+(2.042)+(17.002), (I-746)+(2.042)+(17.003), (I-746)+(2.042)+(17.004), (I-746)+(2.042)+(17.005), (I-746)+(2.042)+(17.006), (I-746)+(2.042)+(17.007), (I-746)+(2.042)+(17.008), (I-746)+(2.042)+(17.009), (I-746)+(2.042)+(17.010), (I-746)+(2.042)+(17.011), (I-746)+(2.042)+(17.012), (I-746)+(2.042)+(18.001),

(I-746)+(2.043)+(3.001), (I-746)+(2.043)+(3.002), (I-746)+(2.043)+(3.003), (I-746)+(2.043)+(3.004), (I-746)+(2.043)+(3.005), (I-746)+(2.043)+(3.006), (I-746)+(2.043)+(3.007), (I-746)+(2.043)+(3.008), (I-746)+(2.043)+(3.009), (I-746)+(2.043)+(3.010), (I-746)+(2.043)+(3.011), (I-746)+(2.043)+(3.012), (I-746)+(2.043)+(3.013), (I-746)+(2.043)+(3.014), (I-746)+(2.043)+(3.015), (I-746)+(2.043)+(3.016), (I-746)+(2.043)+(3.017), (I-746)+(2.043)+(3.018), (I-746)+(2.043)+(3.019), (I-746)+(2.043)+(3.020), (I-746)+(2.043)+(3.021), (I-746)+(2.043)+(3.022), (I-746)+(2.043)+(3.023), (I-746)+(2.043)+(3.024), (I-746)+(2.043)+(3.025), (I-746)+(2.043)+(3.026), (I-746)+(2.043)+(3.027), (I-746)+(2.043)+(3.028), (I-746)+(2.043)+(3.029), (I-746)+(2.043)+(3.030), (I-746)+(2.043)+(3.031), (I-746)+(2.043)+(5.001), (I-746)+(2.043)+(5.002), (I-746)+(2.043)+(5.003), (I-746)+(2.043)+(5.004), (I-746)+(2.043)+(5.005), (I-746)+(2.043)+(5.006), (I-746)+(2.043)+(5.007), (I-746)+(2.043)+(5.008), (I-746)+(2.043)+(5.009), (I-746)+(2.043)+(5.010), (I-746)+(2.043)+(5.011), (I-746)+(2.043)+(5.012), (I-746)+(2.043)+(5.013), (I-746)+(2.043)+(5.014), (I-746)+(2.043)+(5.015), (I-746)+(2.043)+(5.016), (I-746)+(2.043)+(5.017), (I-746)+(2.043)+(5.018), (I-746)+(2.043)+(5.019), (I-746)+(2.043)+(5.020), (I-746)+(2.043)+(5.021), (I-746)+(2.043)+(5.022), (I-746)+(2.043)+(5.023), (I-746)+(2.043)+(6.001), (I-746)+(2.043)+(6.002), (I-746)+(2.043)+(6.003), (I-746)+(2.043)+(6.004), (I-746)+(2.043)+(7.001), (I-746)+(2.043)+(7.002), (I-746)+(2.043)+(7.003), (I-746)+(2.043)+(7.004), (I-746)+(2.043)+(7.005), (I-746)+(2.043)+(7.006), (I-746)+(2.043)+(9.001), (I-746)+(2.043)+(9.002), (I-746)+(2.043)+(9.003), (I-746)+(2.043)+(9.004), (I-746)+(2.043)+(9.005), (I-746)+(2.043)+(9.006), (I-746)+(2.043)+(9.007), (I-746)+(2.043)+(9.008), (I-746)+(2.043)+(9.009), (I-746)+(2.043)+(14.001), (I-746)+(2.043)+(14.002), (I-746)+(2.043)+(15.008), (I-746)+(2.043)+(15.011), (I-746)+(2.043)+(15.012), (I-746)+(2.043)+(15.016), (I-746)+(2.043)+(15.025), (I-746)+(2.043)+(15.027), (I-746)+(2.043)+(15.047), (I-746)+(2.043)+(15.063), (I-746)+(2.043)+(15.064), (I-746)+(2.043)+(16.001), (I-746)+(2.043)+(16.002), (I-746)+(2.043)+(16.003), (I-746)+(2.043)+(16.004), (I-746)+(2.043)+(16.005), (I-746)+(2.043)+(16.006), (I-746)+(2.043)+(16.007), (I-746)+(2.043)+(16.008), (I-746)+(2.043)+(17.001), (I-746)+(2.043)+(17.002), (I-746)+(2.043)+(17.003), (I-746)+(2.043)+(17.004), (I-746)+(2.043)+(17.005), (I-746)+(2.043)+(17.006), (I-746)+(2.043)+(17.007), (I-746)+(2.043)+(17.008), (I-746)+(2.043)+(17.009), (I-746)+(2.043)+(17.010), (I-746)+(2.043)+(17.011), (I-746)+(2.043)+(17.012), (I-746)+(2.043)+(18.001),

(I-746)+(2.044)+(3.001), (I-746)+(2.044)+(3.002), (I-746)+(2.044)+(3.003), (I-746)+(2.044)+(3.004), (I-746)+(2.044)+(3.005), (I-746)+(2.044)+(3.006), (I-746)+(2.044)+(3.007), (I-746)+(2.044)+(3.008), (I-746)+(2.044)+(3.009), (I-746)+(2.044)+(3.010), (I-746)+(2.044)+(3.011), (I-746)+(2.044)+(3.012), (I-746)+(2.044)+(3.013), (I-746)+(2.044)+(3.014), (I-746)+(2.044)+(3.015), (I-746)+(2.044)+(3.016), (I-746)+(2.044)+(3.017), (I-746)+(2.044)+(3.018), (I-746)+(2.044)+(3.019), (I-746)+(2.044)+(3.020), (I-746)+(2.044)+(3.021), (I-746)+(2.044)+(3.022), (I-746)+(2.044)+(3.023), (I-746)+(2.044)+(3.024), (I-746)+(2.044)+(3.025), (I-746)+(2.044)+(3.026), (I-746)+(2.044)+(3.027), (I-746)+(2.044)+(3.028), (I-746)+(2.044)+(3.029), (I-746)+(2.044)+(3.030), (I-746)+(2.044)+(3.031), (I-746)+(2.044)+(5.001), (I-746)+(2.044)+(5.002), (I-746)+(2.044)+(5.003), (I-746)+(2.044)+(5.004), (I-746)+(2.044)+(5.005), (I-746)+(2.044)+(5.006), (I-746)+(2.044)+(5.007), (I-746)+(2.044)+(5.008), (I-746)+(2.044)+(5.009), (I-746)+(2.044)+(5.010), (I-746)+(2.044)+(5.011), (I-746)+(2.044)+(5.012), (I-746)+(2.044)+(5.013), (I-746)+(2.044)+(5.014), (I-746)+(2.044)+(5.015), (I-746)+(2.044)+(5.016), (I-746)+(2.044)+(5.017), (I-746)+(2.044)+(5.018), (I-746)+(2.044)+(5.019), (I-746)+(2.044)+(5.020), (I-746)+(2.044)+(5.021), (I-746)+(2.044)+(5.022), (I-746)+(2.044)+(5.023), (I-746)+(2.044)+(6.001), (I-746)+(2.044)+(6.002), (I-746)+(2.044)+(6.003), (I-746)+(2.044)+(6.004), (I-746)+(2.044)+(7.001), (I-746)+(2.044)+(7.002), (I-746)+(2.044)+(7.003), (I-746)+(2.044)+(7.004), (I-746)+(2.044)+(7.005), (I-746)+(2.044)+(7.006), (I-746)+(2.044)+(9.001), (I-746)+(2.044)+(9.002), (I-746)+(2.044)+(9.003), (I-746)+(2.044)+(9.004), (I-746)+(2.044)+(9.005), (I-746)+(2.044)+(9.006), (I-746)+(2.044)+(9.007), (I-746)+(2.044)+(9.008), (I-746)+(2.044)+(9.009), (I-746)+(2.044)+(14.001), (I-746)+(2.044)+(14.002), (I-746)+(2.044)+(15.008), (I-746)+(2.044)+(15.011), (I-746)+(2.044)+(15.012), (I-746)+(2.044)+(15.016), (I-746)+(2.044)+(15.025), (I-746)+(2.044)+(15.027), (I-746)+(2.044)+(15.047), (I-746)+(2.044)+(15.063), (I-746)+(2.044)+(15.064), (I-746)+(2.044)+(16.001), (I-746)+(2.044)+(16.002), (I-746)+(2.044)+(16.003), (I-746)+(2.044)+(16.004), (I-746)+(2.044)+(16.005), (I-746)+(2.044)+(16.006), (I-746)+(2.044)+(16.007), (I-746)+(2.044)+(16.008), (I-746)+(2.044)+(17.001), (I-746)+(2.044)+(17.002), (I-746)+(2.044)+(17.003), (I-746)+(2.044)+(17.004), (I-746)+(2.044)+(17.005), (I-746)+(2.044)+(17.006), (I-746)+(2.044)+(17.007), (I-746)+(2.044)+(17.008), (I-746)+(2.044)+(17.009), (I-746)+(2.044)+(17.010), (I-746)+(2.044)+(17.011), (I-746)+(2.044)+(17.012), (I-746)+(2.044)+(18.001),

(I-746)+(2.045)+(3.001), (I-746)+(2.045)+(3.002), (I-746)+(2.045)+(3.003), (I-746)+(2.045)+(3.004), (I-746)+(2.045)+(3.005), (I-746)+(2.045)+(3.006), (I-746)+(2.045)+(3.007), (I-746)+(2.045)+(3.008), (I-746)+(2.045)+(3.009), (I-746)+(2.045)+(3.010), (I-746)+(2.045)+(3.011), (I-746)+(2.045)+(3.012), (I-746)+(2.045)+(3.013), (I-746)+(2.045)+(3.014), (I-746)+(2.045)+(3.015), (I-746)+(2.045)+(3.016), (I-746)+(2.045)+(3.017), (I-746)+(2.045)+(3.018), (I-746)+(2.045)+(3.019), (I-746)+(2.045)+(3.020), (I-746)+(2.045)+(3.021), (I-746)+(2.045)+(3.022), (I-746)+(2.045)+(3.023), (I-746)+(2.045)+(3.024), (I-746)+(2.045)+(3.025), (I-746)+(2.045)+(3.026), (I-746)+(2.045)+(3.027), (I-746)+(2.045)+(3.028), (I-746)+(2.045)+(3.029), (I-746)+(2.045)+(3.030), (I-746)+(2.045)+(3.031), (I-746)+(2.045)+(5.001), (I-746)+(2.045)+(5.002), (I-746)+(2.045)+(5.003), (I-746)+(2.045)+(5.004), (I-746)+(2.045)+(5.005), (I-746)+(2.045)+(5.006), (I-746)+(2.045)+(5.007), (I-746)+(2.045)+(5.008), (I-746)+(2.045)+(5.009), (I-746)+(2.045)+(5.010), (I-746)+(2.045)+(5.011), (I-746)+(2.045)+(5.012), (I-746)+(2.045)+(5.013), (I-746)+(2.045)+(5.014), (I-746)+(2.045)+(5.015), (I-746)+(2.045)+(5.016), (I-746)+(2.045)+(5.017), (I-746)+(2.045)+(5.018), (I-746)+(2.045)+(5.019), (I-746)+(2.045)+(5.020), (I-746)+(2.045)+(5.021), (I-746)+(2.045)+(5.022), (I-746)+(2.045)+(5.023), (I-746)+(2.045)+(6.001), (I-746)+(2.045)+(6.002), (I-746)+(2.045)+(6.003), (I-746)+(2.045)+(6.004), (I-746)+(2.045)+(7.001), (I-746)+(2.045)+(7.002), (I-746)+(2.045)+(7.003), (I-746)+(2.045)+(7.004), (I-746)+(2.045)+(7.005), (I-746)+(2.045)+(7.006), (I-746)+(2.045)+(9.001), (I-746)+(2.045)+(9.002), (I-746)+(2.045)+(9.003), (I-746)+(2.045)+(9.004), (I-746)+(2.045)+(9.005), (I-746)+(2.045)+(9.006), (I-746)+(2.045)+(9.007), (I-746)+(2.045)+(9.008), (I-746)+(2.045)+(9.009), (I-746)+(2.045)+(14.001), (I-746)+(2.045)+(14.002), (I-746)+(2.045)+(15.008), (I-746)+(2.045)+(15.011), (I-746)+(2.045)+(15.012), (I-746)+(2.045)+(15.016), (I-746)+(2.045)+(15.025), (I-746)+(2.045)+(15.027), (I-746)+(2.045)+(15.047), (I-746)+(2.045)+(15.063), (I-746)+(2.045)+(15.064), (I-746)+(2.045)+(16.001), (I-746)+(2.045)+(16.002), (I-746)+(2.045)+(16.003), (I-746)+(2.045)+(16.004), (I-746)+(2.045)+(16.005), (I-746)+(2.045)+(16.006), (I-746)+(2.045)+(16.007), (I-746)+(2.045)+(16.008), (I-746)+(2.045)+(17.001), (I-746)+(2.045)+(17.002), (I-746)+(2.045)+(17.003), (I-746)+(2.045)+(17.004), (I-746)+(2.045)+(17.005), (I-746)+(2.045)+(17.006), (I-746)+(2.045)+(17.007), (I-746)+(2.045)+(17.008), (I-746)+(2.045)+(17.009), (I-746)+(2.045)+(17.010), (I-746)+(2.045)+(17.011), (I-746)+(2.045)+(17.012), (I-746)+(2.045)+(18.001),

(I-746)+(2.046)+(3.001), (I-746)+(2.046)+(3.002), (I-746)+(2.046)+(3.003), (I-746)+(2.046)+(3.004), (I-746)+(2.046)+(3.005), (I-746)+(2.046)+(3.006), (I-746)+(2.046)+(3.007), (I-746)+(2.046)+(3.008), (I-746)+(2.046)+(3.009), (I-746)+(2.046)+(3.010), (I-746)+(2.046)+(3.011), (I-746)+(2.046)+(3.012), (I-746)+(2.046)+(3.013), (I-746)+(2.046)+(3.014), (I-746)+(2.046)+(3.015), (I-746)+(2.046)+(3.016), (I-746)+(2.046)+(3.017), (I-746)+(2.046)+(3.018), (I-746)+(2.046)+(3.019), (I-746)+(2.046)+(3.020), (I-746)+(2.046)+(3.021), (I-746)+(2.046)+(3.022), (I-746)+(2.046)+(3.023), (I-746)+(2.046)+(3.024), (I-746)+(2.046)+(3.025), (I-746)+(2.046)+(3.026), (I-746)+(2.046)+(3.027), (I-746)+(2.046)+(3.028), (I-746)+(2.046)+(3.029), (I-746)+(2.046)+(3.030), (I-746)+(2.046)+(3.031), (I-746)+(2.046)+(5.001), (I-746)+(2.046)+(5.002), (I-746)+(2.046)+(5.003), (I-746)+(2.046)+(5.004), (I-746)+(2.046)+(5.005), (I-746)+(2.046)+(5.006), (I-746)+(2.046)+(5.007), (I-746)+(2.046)+(5.008), (I-746)+(2.046)+(5.009), (I-746)+(2.046)+(5.010), (I-746)+(2.046)+(5.011), (I-746)+(2.046)+(5.012), (I-746)+(2.046)+(5.013), (I-746)+(2.046)+(5.014), (I-746)+(2.046)+(5.015), (I-746)+(2.046)+(5.016), (I-746)+(2.046)+(5.017), (I-746)+(2.046)+(5.018), (I-746)+(2.046)+(5.019), (I-746)+(2.046)+(5.020), (I-746)+(2.046)+(5.021), (I-746)+(2.046)+(5.022), (I-746)+(2.046)+(5.023), (I-746)+(2.046)+(6.001), (I-746)+(2.046)+(6.002), (I-746)+(2.046)+(6.003), (I-746)+(2.046)+(6.004), (I-746)+(2.046)+(7.001), (I-746)+(2.046)+(7.002), (I-746)+(2.046)+(7.003), (I-746)+(2.046)+(7.004), (I-746)+(2.046)+(7.005), (I-746)+(2.046)+(7.006), (I-746)+(2.046)+(9.001), (I-746)+(2.046)+(9.002), (I-746)+(2.046)+(9.003), (I-746)+(2.046)+(9.004), (I-746)+(2.046)+(9.005), (I-746)+(2.046)+(9.006), (I-746)+(2.046)+(9.007), (I-746)+(2.046)+(9.008), (I-746)+(2.046)+(9.009), (I-746)+(2.046)+(14.001), (I-746)+(2.046)+(14.002), (I-746)+(2.046)+(15.008), (I-746)+(2.046)+(15.011), (I-746)+(2.046)+(15.012), (I-746)+(2.046)+(15.016), (I-746)+(2.046)+(15.025), (I-746)+(2.046)+(15.027), (I-746)+(2.046)+(15.047), (I-746)+(2.046)+(15.063), (I-746)+(2.046)+(15.064), (I-746)+(2.046)+(16.001), (I-746)+(2.046)+(16.002), (I-746)+(2.046)+(16.003), (I-746)+(2.046)+(16.004), (I-746)+(2.046)+(16.005), (I-746)+(2.046)+(16.006), (I-746)+(2.046)+(16.007), (I-746)+(2.046)+(16.008), (I-746)+(2.046)+(17.001), (I-746)+(2.046)+(17.002), (I-746)+(2.046)+(17.003), (I-746)+(2.046)+(17.004), (I-746)+(2.046)+(17.005), (I-746)+(2.046)+(17.006), (I-746)+(2.046)+(17.007), (I-746)+(2.046)+(17.008), (I-746)+(2.046)+(17.009), (I-746)+(2.046)+(17.010), (I-746)+(2.046)+(17.011), (I-746)+(2.046)+(17.012), (I-746)+(2.046)+(18.001),

(I-746)+(2.047)+(3.001), (I-746)+(2.047)+(3.002), (I-746)+(2.047)+(3.003), (I-746)+(2.047)+(3.004), (I-746)+(2.047)+(3.005), (I-746)+(2.047)+(3.006), (I-746)+(2.047)+(3.007), (I-746)+(2.047)+(3.008), (I-746)+(2.047)+(3.009), (I-746)+(2.047)+(3.010), (I-746)+(2.047)+(3.011), (I-746)+(2.047)+(3.012), (I-746)+(2.047)+(3.013), (I-746)+(2.047)+(3.014), (I-746)+(2.047)+(3.015), (I-746)+(2.047)+(3.016), (I-746)+(2.047)+(3.017), (I-746)+(2.047)+(3.018), (I-746)+(2.047)+(3.019), (I-746)+(2.047)+(3.020), (I-746)+(2.047)+(3.021), (I-746)+(2.047)+(3.022), (I-746)+(2.047)+(3.023), (I-746)+(2.047)+(3.024), (I-746)+(2.047)+(3.025), (I-746)+(2.047)+(3.026), (I-746)+(2.047)+(3.027), (I-746)+(2.047)+(3.028), (I-746)+(2.047)+(3.029), (I-746)+(2.047)+(3.030), (I-746)+(2.047)+(3.031), (I-746)+(2.047)+(5.001), (I-746)+(2.047)+(5.002), (I-746)+(2.047)+(5.003), (I-746)+(2.047)+(5.004), (I-746)+(2.047)+(5.005), (I-746)+(2.047)+(5.006), (I-746)+(2.047)+(5.007), (I-746)+(2.047)+(5.008), (I-746)+(2.047)+(5.009), (I-746)+(2.047)+(5.010), (I-746)+(2.047)+(5.011), (I-746)+(2.047)+(5.012), (I-746)+(2.047)+(5.013), (I-746)+(2.047)+(5.014), (I-746)+(2.047)+(5.015), (I-746)+(2.047)+(5.016), (I-746)+(2.047)+(5.017), (I-746)+(2.047)+(5.018), (I-746)+(2.047)+(5.019), (I-746)+(2.047)+(5.020), (I-746)+(2.047)+(5.021), (I-746)+(2.047)+(5.022), (I-746)+(2.047)+(5.023), (I-746)+(2.047)+(6.001), (I-746)+(2.047)+(6.002), (I-746)+(2.047)+(6.003), (I-746)+(2.047)+(6.004), (I-746)+(2.047)+(7.001), (I-746)+(2.047)+(7.002), (I-746)+(2.047)+(7.003), (I-746)+(2.047)+(7.004), (I-746)+(2.047)+(7.005), (I-746)+(2.047)+(7.006), (I-746)+(2.047)+(9.001), (I-746)+(2.047)+(9.002), (I-746)+(2.047)+(9.003), (I-746)+(2.047)+(9.004), (I-746)+(2.047)+(9.005), (I-746)+(2.047)+(9.006), (I-746)+(2.047)+(9.007), (I-746)+(2.047)+(9.008), (I-746)+(2.047)+(9.009), (I-746)+(2.047)+(14.001), (I-746)+(2.047)+(14.002), (I-746)+(2.047)+(15.008), (I-746)+(2.047)+(15.011), (I-746)+(2.047)+(15.012), (I-746)+(2.047)+(15.016), (I-746)+(2.047)+(15.025), (I-746)+(2.047)+(15.027), (I-746)+(2.047)+(15.047), (I-746)+(2.047)+(15.063), (I-746)+(2.047)+(15.064), (I-746)+(2.047)+(16.001), (I-746)+(2.047)+(16.002), (I-746)+(2.047)+(16.003), (I-746)+(2.047)+(16.004), (I-746)+(2.047)+(16.005), (I-746)+(2.047)+(16.006), (I-746)+(2.047)+(16.007), (I-746)+(2.047)+(16.008), (I-746)+(2.047)+(17.001), (I-746)+(2.047)+(17.002), (I-746)+(2.047)+(17.003), (I-746)+(2.047)+(17.004), (I-746)+(2.047)+(17.005), (I-746)+(2.047)+(17.006), (I-746)+(2.047)+(17.007), (I-746)+(2.047)+(17.008), (I-746)+(2.047)+(17.009), (I-746)+(2.047)+(17.010), (I-746)+(2.047)+(17.011), (I-746)+(2.047)+(17.012), (I-746)+(2.047)+(18.001),

(I-746)+(2.048)+(3.001), (I-746)+(2.048)+(3.002), (I-746)+(2.048)+(3.003), (I-746)+(2.048)+(3.004), (I-746)+(2.048)+(3.005), (I-746)+(2.048)+(3.006), (I-746)+(2.048)+(3.007), (I-746)+(2.048)+(3.008), (I-746)+(2.048)+(3.009), (I-746)+(2.048)+(3.010), (I-746)+(2.048)+(3.011), (I-746)+(2.048)+(3.012), (I-746)+(2.048)+(3.013), (I-746)+(2.048)+(3.014), (I-746)+(2.048)+(3.015), (I-746)+(2.048)+(3.016), (I-746)+(2.048)+(3.017), (I-746)+(2.048)+(3.018), (I-746)+(2.048)+(3.019), (I-746)+(2.048)+(3.020), (I-746)+(2.048)+(3.021), (I-746)+(2.048)+(3.022), (I-746)+(2.048)+(3.023), (I-746)+(2.048)+(3.024), (I-746)+(2.048)+(3.025), (I-746)+(2.048)+(3.026), (I-746)+(2.048)+(3.027), (I-746)+(2.048)+(3.028), (I-746)+(2.048)+(3.029), (I-746)+(2.048)+(3.030), (I-746)+(2.048)+(3.031), (I-746)+(2.048)+(5.001), (I-746)+(2.048)+(5.002), (I-746)+(2.048)+(5.003), (I-746)+(2.048)+(5.004), (I-746)+(2.048)+(5.005), (I-746)+(2.048)+(5.006), (I-746)+(2.048)+(5.007), (I-746)+(2.048)+(5.008), (I-746)+(2.048)+(5.009), (I-746)+(2.048)+(5.010), (I-746)+(2.048)+(5.011), (I-746)+(2.048)+(5.012), (I-746)+(2.048)+(5.013), (I-746)+(2.048)+(5.014), (I-746)+(2.048)+(5.015), (I-746)+(2.048)+(5.016), (I-746)+(2.048)+(5.017), (I-746)+(2.048)+(5.018), (I-746)+(2.048)+(5.019), (I-746)+(2.048)+(5.020), (I-746)+(2.048)+(5.021), (I-746)+(2.048)+(5.022), (I-746)+(2.048)+(5.023), (I-746)+(2.048)+(6.001), (I-746)+(2.048)+(6.002), (I-746)+(2.048)+(6.003), (I-746)+(2.048)+(6.004), (I-746)+(2.048)+(7.001), (I-746)+(2.048)+(7.002), (I-746)+(2.048)+(7.003), (I-746)+(2.048)+(7.004), (I-746)+(2.048)+(7.005), (I-746)+(2.048)+(7.006), (I-746)+(2.048)+(9.001), (I-746)+(2.048)+(9.002), (I-746)+(2.048)+(9.003), (I-746)+(2.048)+(9.004), (I-746)+(2.048)+(9.005), (I-746)+(2.048)+(9.006), (I-746)+(2.048)+(9.007), (I-746)+(2.048)+(9.008), (I-746)+(2.048)+(9.009), (I-746)+(2.048)+(14.001), (I-746)+(2.048)+(14.002), (I-746)+(2.048)+(15.008), (I-746)+(2.048)+(15.011), (I-746)+(2.048)+(15.012), (I-746)+(2.048)+(15.016), (I-746)+(2.048)+(15.025), (I-746)+(2.048)+(15.027), (I-746)+(2.048)+(15.047), (I-746)+(2.048)+(15.063), (I-746)+(2.048)+(15.064), (I-746)+(2.048)+(16.001), (I-746)+(2.048)+(16.002), (I-746)+(2.048)+(16.003), (I-746)+(2.048)+(16.004), (I-746)+(2.048)+(16.005), (I-746)+(2.048)+(16.006), (I-746)+(2.048)+(16.007), (I-746)+(2.048)+(16.008), (I-746)+(2.048)+(17.001), (I-746)+(2.048)+(17.002), (I-746)+(2.048)+(17.003), (I-746)+(2.048)+(17.004), (I-746)+(2.048)+(17.005), (I-746)+(2.048)+(17.006), (I-746)+(2.048)+(17.007), (I-746)+(2.048)+(17.008), (I-746)+(2.048)+(17.009), (I-746)+(2.048)+(17.010), (I-746)+(2.048)+(17.011), (I-746)+(2.048)+(17.012), (I-746)+(2.048)+(18.001),

(I-746)+(2.049)+(3.001), (I-746)+(2.049)+(3.002), (I-746)+(2.049)+(3.003), (I-746)+(2.049)+(3.004), (I-746)+(2.049)+(3.005), (I-746)+(2.049)+(3.006), (I-746)+(2.049)+(3.007), (I-746)+(2.049)+(3.008), (I-746)+(2.049)+(3.009), (I-746)+(2.049)+(3.010), (I-746)+(2.049)+(3.011), (I-746)+(2.049)+(3.012), (I-746)+(2.049)+(3.013), (I-746)+(2.049)+(3.014), (I-746)+(2.049)+(3.015), (I-746)+(2.049)+(3.016), (I-746)+(2.049)+(3.017), (I-746)+(2.049)+(3.018), (I-746)+(2.049)+(3.019), (I-746)+(2.049)+(3.020), (I-746)+(2.049)+(3.021), (I-746)+(2.049)+(3.022), (I-746)+(2.049)+(3.023), (I-746)+(2.049)+(3.024), (I-746)+(2.049)+(3.025), (I-746)+(2.049)+(3.026), (I-746)+(2.049)+(3.027), (I-746)+(2.049)+(3.028), (I-746)+(2.049)+(3.029), (I-746)+(2.049)+(3.030), (I-746)+(2.049)+(3.031), (I-746)+(2.049)+(5.001), (I-746)+(2.049)+(5.002), (I-746)+(2.049)+(5.003), (I-746)+(2.049)+(5.004), (I-746)+(2.049)+(5.005), (I-746)+(2.049)+(5.006), (I-746)+(2.049)+(5.007), (I-746)+(2.049)+(5.008), (I-746)+(2.049)+(5.009), (I-746)+(2.049)+(5.010), (I-746)+(2.049)+(5.011), (I-746)+(2.049)+(5.012), (I-746)+(2.049)+(5.013), (I-746)+(2.049)+(5.014), (I-746)+(2.049)+(5.015), (I-746)+(2.049)+(5.016), (I-746)+(2.049)+(5.017), (I-746)+(2.049)+(5.018), (I-746)+(2.049)+(5.019), (I-746)+(2.049)+(5.020), (I-746)+(2.049)+(5.021), (I-746)+(2.049)+(5.022), (I-746)+(2.049)+(5.023), (I-746)+(2.049)+(6.001), (I-746)+(2.049)+(6.002), (I-746)+(2.049)+(6.003), (I-746)+(2.049)+(6.004), (I-746)+(2.049)+(7.001), (I-746)+(2.049)+(7.002), (I-746)+(2.049)+(7.003), (I-746)+(2.049)+(7.004), (I-746)+(2.049)+(7.005), (I-746)+(2.049)+(7.006), (I-746)+(2.049)+(9.001), (I-746)+(2.049)+(9.002), (I-746)+(2.049)+(9.003), (I-746)+(2.049)+(9.004), (I-746)+(2.049)+(9.005), (I-746)+(2.049)+(9.006), (I-746)+(2.049)+(9.007), (I-746)+(2.049)+(9.008), (I-746)+(2.049)+(9.009), (I-746)+(2.049)+(14.001), (I-746)+(2.049)+(14.002), (I-746)+(2.049)+(15.008), (I-746)+(2.049)+(15.011), (I-746)+(2.049)+(15.012), (I-746)+(2.049)+(15.016), (I-746)+(2.049)+(15.025), (I-746)+(2.049)+(15.027), (I-746)+(2.049)+(15.047), (I-746)+(2.049)+(15.063), (I-746)+(2.049)+(15.064), (I-746)+(2.049)+(16.001), (I-746)+(2.049)+(16.002), (I-746)+(2.049)+(16.003), (I-746)+(2.049)+(16.004), (I-746)+(2.049)+(16.005), (I-746)+(2.049)+(16.006), (I-746)+(2.049)+(16.007), (I-746)+(2.049)+(16.008), (I-746)+(2.049)+(17.001), (I-746)+(2.049)+(17.002), (I-746)+(2.049)+(17.003), (I-746)+(2.049)+(17.004), (I-746)+(2.049)+(17.005), (I-746)+(2.049)+(17.006), (I-746)+(2.049)+(17.007), (I-746)+(2.049)+(17.008), (I-746)+(2.049)+(17.009), (I-746)+(2.049)+(17.010), (I-746)+(2.049)+(17.011), (I-746)+(2.049)+(17.012), (I-746)+(2.049)+(18.001),

(I-746)+(2.050)+(3.001), (I-746)+(2.050)+(3.002), (I-746)+(2.050)+(3.003), (I-746)+(2.050)+(3.004), (I-746)+(2.050)+(3.005), (I-746)+(2.050)+(3.006), (I-746)+(2.050)+(3.007), (I-746)+(2.050)+(3.008), (I-746)+(2.050)+(3.009), (I-746)+(2.050)+(3.010), (I-746)+(2.050)+(3.011), (I-746)+(2.050)+(3.012), (I-746)+(2.050)+(3.013), (I-746)+(2.050)+(3.014), (I-746)+(2.050)+(3.015), (I-746)+(2.050)+(3.016), (I-746)+(2.050)+(3.017), (I-746)+(2.050)+(3.018), (I-746)+(2.050)+(3.019), (I-746)+(2.050)+(3.020), (I-746)+(2.050)+(3.021), (I-746)+(2.050)+(3.022), (I-746)+(2.050)+(3.023), (I-746)+(2.050)+(3.024), (I-746)+(2.050)+(3.025), (I-746)+(2.050)+(3.026), (I-746)+(2.050)+(3.027), (I-746)+(2.050)+(3.028), (I-746)+(2.050)+(3.029), (I-746)+(2.050)+(3.030), (I-746)+(2.050)+(3.031), (I-746)+(2.050)+(5.001), (I-746)+(2.050)+(5.002), (I-746)+(2.050)+(5.003), (I-746)+(2.050)+(5.004), (I-746)+(2.050)+(5.005), (I-746)+(2.050)+(5.006), (I-746)+(2.050)+(5.007), (I-746)+(2.050)+(5.008), (I-746)+(2.050)+(5.009), (I-746)+(2.050)+(5.010), (I-746)+(2.050)+(5.011), (I-746)+(2.050)+(5.012), (I-746)+(2.050)+(5.013), (I-746)+(2.050)+(5.014), (I-746)+(2.050)+(5.015), (I-746)+(2.050)+(5.016), (I-746)+(2.050)+(5.017), (I-746)+(2.050)+(5.018), (I-746)+(2.050)+(5.019), (I-746)+(2.050)+(5.020), (I-746)+(2.050)+(5.021), (I-746)+(2.050)+(5.022), (I-746)+(2.050)+(5.023), (I-746)+(2.050)+(6.001), (I-746)+(2.050)+(6.002), (I-746)+(2.050)+(6.003), (I-746)+(2.050)+(6.004), (I-746)+(2.050)+(7.001), (I-746)+(2.050)+(7.002), (I-746)+(2.050)+(7.003), (I-746)+(2.050)+(7.004), (I-746)+(2.050)+(7.005), (I-746)+(2.050)+(7.006), (I-746)+(2.050)+(9.001), (I-746)+(2.050)+(9.002), (I-746)+(2.050)+(9.003), (I-746)+(2.050)+(9.004), (I-746)+(2.050)+(9.005), (I-746)+(2.050)+(9.006), (I-746)+(2.050)+(9.007), (I-746)+(2.050)+(9.008), (I-746)+(2.050)+(9.009), (I-746)+(2.050)+(14.001), (I-746)+(2.050)+(14.002), (I-746)+(2.050)+(15.008), (I-746)+(2.050)+(15.011), (I-746)+(2.050)+(15.012), (I-746)+(2.050)+(15.016), (I-746)+(2.050)+(15.025), (I-746)+(2.050)+(15.027), (I-746)+(2.050)+(15.047), (I-746)+(2.050)+(15.063), (I-746)+(2.050)+(15.064), (I-746)+(2.050)+(16.001), (I-746)+(2.050)+(16.002), (I-746)+(2.050)+(16.003), (I-746)+(2.050)+(16.004), (I-746)+(2.050)+(16.005), (I-746)+(2.050)+(16.006), (I-746)+(2.050)+(16.007), (I-746)+(2.050)+(16.008), (I-746)+(2.050)+(17.001), (I-746)+(2.050)+(17.002), (I-746)+(2.050)+(17.003), (I-746)+(2.050)+(17.004), (I-746)+(2.050)+(17.005), (I-746)+(2.050)+(17.006), (I-746)+(2.050)+(17.007), (I-746)+(2.050)+(17.008), (I-746)+(2.050)+(17.009), (I-746)+(2.050)+(17.010), (I-746)+(2.050)+(17.011), (I-746)+(2.050)+(17.012), (I-746)+(2.050)+(18.001),

(I-746)+(2.051)+(3.001), (I-746)+(2.051)+(3.002), (I-746)+(2.051)+(3.003), (I-746)+(2.051)+(3.004), (I-746)+(2.051)+(3.005), (I-746)+(2.051)+(3.006), (I-746)+(2.051)+(3.007), (I-746)+(2.051)+(3.008), (I-746)+(2.051)+(3.009), (I-746)+(2.051)+(3.010), (I-746)+(2.051)+(3.011), (I-746)+(2.051)+(3.012), (I-746)+(2.051)+(3.013), (I-746)+(2.051)+(3.014), (I-746)+(2.051)+(3.015), (I-746)+(2.051)+(3.016), (I-746)+(2.051)+(3.017), (I-746)+(2.051)+(3.018), (I-746)+(2.051)+(3.019), (I-746)+(2.051)+(3.020), (I-746)+(2.051)+(3.021), (I-746)+(2.051)+(3.022), (I-746)+(2.051)+(3.023), (I-746)+(2.051)+(3.024), (I-746)+(2.051)+(3.025), (I-746)+(2.051)+(3.026), (I-746)+(2.051)+(3.027), (I-746)+(2.051)+(3.028), (I-746)+(2.051)+(3.029), (I-746)+(2.051)+(3.030), (I-746)+(2.051)+(3.031), (I-746)+(2.051)+(5.001), (I-746)+(2.051)+(5.002), (I-746)+(2.051)+(5.003), (I-746)+(2.051)+(5.004), (I-746)+(2.051)+(5.005), (I-746)+(2.051)+(5.006), (I-746)+(2.051)+(5.007), (I-746)+(2.051)+(5.008), (I-746)+(2.051)+(5.009), (I-746)+(2.051)+(5.010), (I-746)+(2.051)+(5.011), (I-746)+(2.051)+(5.012), (I-746)+(2.051)+(5.013), (I-746)+(2.051)+(5.014), (I-746)+(2.051)+(5.015), (I-746)+(2.051)+(5.016), (I-746)+(2.051)+(5.017), (I-746)+(2.051)+(5.018), (I-746)+(2.051)+(5.019), (I-746)+(2.051)+(5.020), (I-746)+(2.051)+(5.021), (I-746)+(2.051)+(5.022), (I-746)+(2.051)+(5.023), (I-746)+(2.051)+(6.001), (I-746)+(2.051)+(6.002), (I-746)+(2.051)+(6.003), (I-746)+(2.051)+(6.004), (I-746)+(2.051)+(7.001), (I-746)+(2.051)+(7.002), (I-746)+(2.051)+(7.003), (I-746)+(2.051)+(7.004), (I-746)+(2.051)+(7.005), (I-746)+(2.051)+(7.006), (I-746)+(2.051)+(9.001), (I-746)+(2.051)+(9.002), (I-746)+(2.051)+(9.003), (I-746)+(2.051)+(9.004), (I-746)+(2.051)+(9.005), (I-746)+(2.051)+(9.006), (I-746)+(2.051)+(9.007), (I-746)+(2.051)+(9.008), (I-746)+(2.051)+(9.009), (I-746)+(2.051)+(14.001), (I-746)+(2.051)+(14.002), (I-746)+(2.051)+(15.008), (I-746)+(2.051)+(15.011), (I-746)+(2.051)+(15.012), (I-746)+(2.051)+(15.016), (I-746)+(2.051)+(15.025), (I-746)+(2.051)+(15.027), (I-746)+(2.051)+(15.047), (I-746)+(2.051)+(15.063), (I-746)+(2.051)+(15.064), (I-746)+(2.051)+(16.001), (I-746)+(2.051)+(16.002), (I-746)+(2.051)+(16.003), (I-746)+(2.051)+(16.004), (I-746)+(2.051)+(16.005), (I-746)+(2.051)+(16.006), (I-746)+(2.051)+(16.007), (I-746)+(2.051)+(16.008), (I-746)+(2.051)+(17.001), (I-746)+(2.051)+(17.002), (I-746)+(2.051)+(17.003), (I-746)+(2.051)+(17.004), (I-746)+(2.051)+(17.005), (I-746)+(2.051)+(17.006), (I-746)+(2.051)+(17.007), (I-746)+(2.051)+(17.008), (I-746)+(2.051)+(17.009), (I-746)+(2.051)+(17.010), (I-746)+(2.051)+(17.011), (I-746)+(2.051)+(17.012), (I-746)+(2.051)+(18.001),

(I-746)+(2.052)+(3.001), (I-746)+(2.052)+(3.002), (I-746)+(2.052)+(3.003), (I-746)+(2.052)+(3.004), (I-746)+(2.052)+(3.005), (I-746)+(2.052)+(3.006), (I-746)+(2.052)+(3.007), (I-746)+(2.052)+(3.008), (I-746)+(2.052)+(3.009), (I-746)+(2.052)+(3.010), (I-746)+(2.052)+(3.011), (I-746)+(2.052)+(3.012), (I-746)+(2.052)+(3.013), (I-746)+(2.052)+(3.014), (I-746)+(2.052)+(3.015), (I-746)+(2.052)+(3.016), (I-746)+(2.052)+(3.017), (I-746)+(2.052)+(3.018), (I-746)+(2.052)+(3.019), (I-746)+(2.052)+(3.020), (I-746)+(2.052)+(3.021), (I-746)+(2.052)+(3.022), (I-746)+(2.052)+(3.023), (I-746)+(2.052)+(3.024), (I-746)+(2.052)+(3.025), (I-746)+(2.052)+(3.026), (I-746)+(2.052)+(3.027), (I-746)+(2.052)+(3.028), (I-746)+(2.052)+(3.029), (I-746)+(2.052)+(3.030), (I-746)+(2.052)+(3.031), (I-746)+(2.052)+(5.001), (I-746)+(2.052)+(5.002), (I-746)+(2.052)+(5.003), (I-746)+(2.052)+(5.004), (I-746)+(2.052)+(5.005), (I-746)+(2.052)+(5.006), (I-746)+(2.052)+(5.007), (I-746)+(2.052)+(5.008), (I-746)+(2.052)+(5.009), (I-746)+(2.052)+(5.010), (I-746)+(2.052)+(5.011), (I-746)+(2.052)+(5.012), (I-746)+(2.052)+(5.013), (I-746)+(2.052)+(5.014), (I-746)+(2.052)+(5.015), (I-746)+(2.052)+(5.016), (I-746)+(2.052)+(5.017), (I-746)+(2.052)+(5.018), (I-746)+(2.052)+(5.019), (I-746)+(2.052)+(5.020), (I-746)+(2.052)+(5.021), (I-746)+(2.052)+(5.022), (I-746)+(2.052)+(5.023), (I-746)+(2.052)+(6.001), (I-746)+(2.052)+(6.002), (I-746)+(2.052)+(6.003), (I-746)+(2.052)+(6.004), (I-746)+(2.052)+(7.001), (I-746)+(2.052)+(7.002), (I-746)+(2.052)+(7.003), (I-746)+(2.052)+(7.004), (I-746)+(2.052)+(7.005), (I-746)+(2.052)+(7.006), (I-746)+(2.052)+(9.001), (I-746)+(2.052)+(9.002), (I-746)+(2.052)+(9.003), (I-746)+(2.052)+(9.004), (I-746)+(2.052)+(9.005), (I-746)+(2.052)+(9.006), (I-746)+(2.052)+(9.007), (I-746)+(2.052)+(9.008), (I-746)+(2.052)+(9.009), (I-746)+(2.052)+(14.001), (I-746)+(2.052)+(14.002), (I-746)+(2.052)+(15.008), (I-746)+(2.052)+(15.011), (I-746)+(2.052)+(15.012), (I-746)+(2.052)+(15.016), (I-746)+(2.052)+(15.025), (I-746)+(2.052)+(15.027), (I-746)+(2.052)+(15.047), (I-746)+(2.052)+(15.063), (I-746)+(2.052)+(15.064), (I-746)+(2.052)+(16.001), (I-746)+(2.052)+(16.002), (I-746)+(2.052)+(16.003), (I-746)+(2.052)+(16.004), (I-746)+(2.052)+(16.005), (I-746)+(2.052)+(16.006), (I-746)+(2.052)+(16.007), (I-746)+(2.052)+(16.008), (I-746)+(2.052)+(17.001), (I-746)+(2.052)+(17.002), (I-746)+(2.052)+(17.003), (I-746)+(2.052)+(17.004), (I-746)+(2.052)+(17.005), (I-746)+(2.052)+(17.006), (I-746)+(2.052)+(17.007), (I-746)+(2.052)+(17.008), (I-746)+(2.052)+(17.009), (I-746)+(2.052)+(17.010), (I-746)+(2.052)+(17.011), (I-746)+(2.052)+(17.012), (I-746)+(2.052)+(18.001),

(I-746)+(2.053)+(3.001), (I-746)+(2.053)+(3.002), (I-746)+(2.053)+(3.003), (I-746)+(2.053)+(3.004), (I-746)+(2.053)+(3.005), (I-746)+(2.053)+(3.006), (I-746)+(2.053)+(3.007), (I-746)+(2.053)+(3.008), (I-746)+(2.053)+(3.009), (I-746)+(2.053)+(3.010), (I-746)+(2.053)+(3.011), (I-746)+(2.053)+(3.012), (I-746)+(2.053)+(3.013), (I-746)+(2.053)+(3.014), (I-746)+(2.053)+(3.015), (I-746)+(2.053)+(3.016), (I-746)+(2.053)+(3.017), (I-746)+(2.053)+(3.018), (I-746)+(2.053)+(3.019), (I-746)+(2.053)+(3.020), (I-746)+(2.053)+(3.021), (I-746)+(2.053)+(3.022), (I-746)+(2.053)+(3.023), (I-746)+(2.053)+(3.024), (I-746)+(2.053)+(3.025), (I-746)+(2.053)+(3.026), (I-746)+(2.053)+(3.027), (I-746)+(2.053)+(3.028), (I-746)+(2.053)+(3.029), (I-746)+(2.053)+(3.030), (I-746)+(2.053)+(3.031), (I-746)+(2.053)+(5.001), (I-746)+(2.053)+(5.002), (I-746)+(2.053)+(5.003), (I-746)+(2.053)+(5.004), (I-746)+(2.053)+(5.005), (I-746)+(2.053)+(5.006), (I-746)+(2.053)+(5.007), (I-746)+(2.053)+(5.008), (I-746)+(2.053)+(5.009), (I-746)+(2.053)+(5.010), (I-746)+(2.053)+(5.011), (I-746)+(2.053)+(5.012), (I-746)+(2.053)+(5.013), (I-746)+(2.053)+(5.014), (I-746)+(2.053)+(5.015), (I-746)+(2.053)+(5.016), (I-746)+(2.053)+(5.017), (I-746)+(2.053)+(5.018), (I-746)+(2.053)+(5.019), (I-746)+(2.053)+(5.020), (I-746)+(2.053)+(5.021), (I-746)+(2.053)+(5.022), (I-746)+(2.053)+(5.023), (I-746)+(2.053)+(6.001), (I-746)+(2.053)+(6.002), (I-746)+(2.053)+(6.003), (I-746)+(2.053)+(6.004), (I-746)+(2.053)+(7.001), (I-746)+(2.053)+(7.002), (I-746)+(2.053)+(7.003), (I-746)+(2.053)+(7.004), (I-746)+(2.053)+(7.005), (I-746)+(2.053)+(7.006), (I-746)+(2.053)+(9.001), (I-746)+(2.053)+(9.002), (I-746)+(2.053)+(9.003), (I-746)+(2.053)+(9.004), (I-746)+(2.053)+(9.005), (I-746)+(2.053)+(9.006), (I-746)+(2.053)+(9.007), (I-746)+(2.053)+(9.008), (I-746)+(2.053)+(9.009), (I-746)+(2.053)+(14.001), (I-746)+(2.053)+(14.002), (I-746)+(2.053)+(15.008), (I-746)+(2.053)+(15.011), (I-746)+(2.053)+(15.012), (I-746)+(2.053)+(15.016), (I-746)+(2.053)+(15.025), (I-746)+(2.053)+(15.027), (I-746)+(2.053)+(15.047), (I-746)+(2.053)+(15.063), (I-746)+(2.053)+(15.064), (I-746)+(2.053)+(16.001), (I-746)+(2.053)+(16.002), (I-746)+(2.053)+(16.003), (I-746)+(2.053)+(16.004), (I-746)+(2.053)+(16.005), (I-746)+(2.053)+(16.006), (I-746)+(2.053)+(16.007), (I-746)+(2.053)+(16.008), (I-746)+(2.053)+(17.001), (I-746)+(2.053)+(17.002), (I-746)+(2.053)+(17.003), (I-746)+(2.053)+(17.004), (I-746)+(2.053)+(17.005), (I-746)+(2.053)+(17.006), (I-746)+(2.053)+(17.007), (I-746)+(2.053)+(17.008), (I-746)+(2.053)+(17.009), (I-746)+(2.053)+(17.010), (I-746)+(2.053)+(17.011), (I-746)+(2.053)+(17.012), (I-746)+(2.053)+(18.001),

(I-746)+(2.054)+(3.001), (I-746)+(2.054)+(3.002), (I-746)+(2.054)+(3.003), (I-746)+(2.054)+(3.004), (I-746)+(2.054)+(3.005), (I-746)+(2.054)+(3.006), (I-746)+(2.054)+(3.007), (I-746)+(2.054)+(3.008), (I-746)+(2.054)+(3.009), (I-746)+(2.054)+(3.010), (I-746)+(2.054)+(3.011), (I-746)+(2.054)+(3.012), (I-746)+(2.054)+(3.013), (I-746)+(2.054)+(3.014), (I-746)+(2.054)+(3.015), (I-746)+(2.054)+(3.016), (I-746)+(2.054)+(3.017), (I-746)+(2.054)+(3.018), (I-746)+(2.054)+(3.019), (I-746)+(2.054)+(3.020), (I-746)+(2.054)+(3.021), (I-746)+(2.054)+(3.022), (I-746)+(2.054)+(3.023), (I-746)+(2.054)+(3.024), (I-746)+(2.054)+(3.025), (I-746)+(2.054)+(3.026), (I-746)+(2.054)+(3.027), (I-746)+(2.054)+(3.028), (I-746)+(2.054)+(3.029), (I-746)+(2.054)+(3.030), (I-746)+(2.054)+(3.031), (I-746)+(2.054)+(5.001), (I-746)+(2.054)+(5.002), (I-746)+(2.054)+(5.003), (I-746)+(2.054)+(5.004), (I-746)+(2.054)+(5.005), (I-746)+(2.054)+(5.006), (I-746)+(2.054)+(5.007), (I-746)+(2.054)+(5.008), (I-746)+(2.054)+(5.009), (I-746)+(2.054)+(5.010), (I-746)+(2.054)+(5.011), (I-746)+(2.054)+(5.012), (I-746)+(2.054)+(5.013), (I-746)+(2.054)+(5.014), (I-746)+(2.054)+(5.015), (I-746)+(2.054)+(5.016), (I-746)+(2.054)+(5.017), (I-746)+(2.054)+(5.018), (I-746)+(2.054)+(5.019), (I-746)+(2.054)+(5.020), (I-746)+(2.054)+(5.021), (I-746)+(2.054)+(5.022), (I-746)+(2.054)+(5.023), (I-746)+(2.054)+(6.001), (I-746)+(2.054)+(6.002), (I-746)+(2.054)+(6.003), (I-746)+(2.054)+(6.004), (I-746)+(2.054)+(7.001), (I-746)+(2.054)+(7.002), (I-746)+(2.054)+(7.003), (I-746)+(2.054)+(7.004), (I-746)+(2.054)+(7.005), (I-746)+(2.054)+(7.006), (I-746)+(2.054)+(9.001), (I-746)+(2.054)+(9.002), (I-746)+(2.054)+(9.003), (I-746)+(2.054)+(9.004), (I-746)+(2.054)+(9.005), (I-746)+(2.054)+(9.006), (I-746)+(2.054)+(9.007), (I-746)+(2.054)+(9.008), (I-746)+(2.054)+(9.009), (I-746)+(2.054)+(14.001), (I-746)+(2.054)+(14.002), (I-746)+(2.054)+(15.008), (I-746)+(2.054)+(15.011), (I-746)+(2.054)+(15.012), (I-746)+(2.054)+(15.016), (I-746)+(2.054)+(15.025), (I-746)+(2.054)+(15.027), (I-746)+(2.054)+(15.047), (I-746)+(2.054)+(15.063), (I-746)+(2.054)+(15.064), (I-746)+(2.054)+(16.001), (I-746)+(2.054)+(16.002), (I-746)+(2.054)+(16.003), (I-746)+(2.054)+(16.004), (I-746)+(2.054)+(16.005), (I-746)+(2.054)+(16.006), (I-746)+(2.054)+(16.007), (I-746)+(2.054)+(16.008), (I-746)+(2.054)+(17.001), (I-746)+(2.054)+(17.002), (I-746)+(2.054)+(17.003), (I-746)+(2.054)+(17.004), (I-746)+(2.054)+(17.005), (I-746)+(2.054)+(17.006), (I-746)+(2.054)+(17.007), (I-746)+(2.054)+(17.008), (I-746)+(2.054)+(17.009), (I-746)+(2.054)+(17.010), (I-746)+(2.054)+(17.011), (I-746)+(2.054)+(17.012), (I-746)+(2.054)+(18.001),

(I-746)+(2.055)+(3.001), (I-746)+(2.055)+(3.002), (I-746)+(2.055)+(3.003), (I-746)+(2.055)+(3.004), (I-746)+(2.055)+(3.005), (I-746)+(2.055)+(3.006), (I-746)+(2.055)+(3.007), (I-746)+(2.055)+(3.008), (I-746)+(2.055)+(3.009), (I-746)+(2.055)+(3.010), (I-746)+(2.055)+(3.011), (I-746)+(2.055)+(3.012), (I-746)+(2.055)+(3.013), (I-746)+(2.055)+(3.014), (I-746)+(2.055)+(3.015), (I-746)+(2.055)+(3.016), (I-746)+(2.055)+(3.017), (I-746)+(2.055)+(3.018), (I-746)+(2.055)+(3.019), (I-746)+(2.055)+(3.020), (I-746)+(2.055)+(3.021), (I-746)+(2.055)+(3.022), (I-746)+(2.055)+(3.023), (I-746)+(2.055)+(3.024), (I-746)+(2.055)+(3.025), (I-746)+(2.055)+(3.026), (I-746)+(2.055)+(3.027), (I-746)+(2.055)+(3.028), (I-746)+(2.055)+(3.029), (I-746)+(2.055)+(3.030), (I-746)+(2.055)+(3.031), (I-746)+(2.055)+(5.001), (I-746)+(2.055)+(5.002), (I-746)+(2.055)+(5.003), (I-746)+(2.055)+(5.004), (I-746)+(2.055)+(5.005), (I-746)+(2.055)+(5.006), (I-746)+(2.055)+(5.007), (I-746)+(2.055)+(5.008), (I-746)+(2.055)+(5.009), (I-746)+(2.055)+(5.010), (I-746)+(2.055)+(5.011), (I-746)+(2.055)+(5.012), (I-746)+(2.055)+(5.013), (I-746)+(2.055)+(5.014), (I-746)+(2.055)+(5.015), (I-746)+(2.055)+(5.016), (I-746)+(2.055)+(5.017), (I-746)+(2.055)+(5.018), (I-746)+(2.055)+(5.019), (I-746)+(2.055)+(5.020), (I-746)+(2.055)+(5.021), (I-746)+(2.055)+(5.022), (I-746)+(2.055)+(5.023), (I-746)+(2.055)+(6.001), (I-746)+(2.055)+(6.002), (I-746)+(2.055)+(6.003), (I-746)+(2.055)+(6.004), (I-746)+(2.055)+(7.001), (I-746)+(2.055)+(7.002), (I-746)+(2.055)+(7.003), (I-746)+(2.055)+(7.004), (I-746)+(2.055)+(7.005), (I-746)+(2.055)+(7.006), (I-746)+(2.055)+(9.001), (I-746)+(2.055)+(9.002), (I-746)+(2.055)+(9.003), (I-746)+(2.055)+(9.004), (I-746)+(2.055)+(9.005), (I-746)+(2.055)+(9.006), (I-746)+(2.055)+(9.007), (I-746)+(2.055)+(9.008), (I-746)+(2.055)+(9.009), (I-746)+(2.055)+(14.001), (I-746)+(2.055)+(14.002), (I-746)+(2.055)+(15.008), (I-746)+(2.055)+(15.011), (I-746)+(2.055)+(15.012), (I-746)+(2.055)+(15.016), (I-746)+(2.055)+(15.025), (I-746)+(2.055)+(15.027), (I-746)+(2.055)+(15.047), (I-746)+(2.055)+(15.063), (I-746)+(2.055)+(15.064), (I-746)+(2.055)+(16.001), (I-746)+(2.055)+(16.002), (I-746)+(2.055)+(16.003), (I-746)+(2.055)+(16.004), (I-746)+(2.055)+(16.005), (I-746)+(2.055)+(16.006), (I-746)+(2.055)+(16.007), (I-746)+(2.055)+(16.008), (I-746)+(2.055)+(17.001), (I-746)+(2.055)+(17.002), (I-746)+(2.055)+(17.003), (I-746)+(2.055)+(17.004), (I-746)+(2.055)+(17.005), (I-746)+(2.055)+(17.006), (I-746)+(2.055)+(17.007), (I-746)+(2.055)+(17.008), (I-746)+(2.055)+(17.009), (I-746)+(2.055)+(17.010), (I-746)+(2.055)+(17.011), (I-746)+(2.055)+(17.012), (I-746)+(2.055)+(18.001),

(I-746)+(2.056)+(3.001), (I-746)+(2.056)+(3.002), (I-746)+(2.056)+(3.003), (I-746)+(2.056)+(3.004), (I-746)+(2.056)+(3.005), (I-746)+(2.056)+(3.006), (I-746)+(2.056)+(3.007), (I-746)+(2.056)+(3.008), (I-746)+(2.056)+(3.009), (I-746)+(2.056)+(3.010), (I-746)+(2.056)+(3.011), (I-746)+(2.056)+(3.012), (I-746)+(2.056)+(3.013), (I-746)+(2.056)+(3.014), (I-746)+(2.056)+(3.015), (I-746)+(2.056)+(3.016), (I-746)+(2.056)+(3.017), (I-746)+(2.056)+(3.018), (I-746)+(2.056)+(3.019), (I-746)+(2.056)+(3.020), (I-746)+(2.056)+(3.021), (I-746)+(2.056)+(3.022), (I-746)+(2.056)+(3.023), (I-746)+(2.056)+(3.024), (I-746)+(2.056)+(3.025), (I-746)+(2.056)+(3.026), (I-746)+(2.056)+(3.027), (I-746)+(2.056)+(3.028), (I-746)+(2.056)+(3.029), (I-746)+(2.056)+(3.030), (I-746)+(2.056)+(3.031), (I-746)+(2.056)+(5.001), (I-746)+(2.056)+(5.002), (I-746)+(2.056)+(5.003), (I-746)+(2.056)+(5.004), (I-746)+(2.056)+(5.005), (I-746)+(2.056)+(5.006), (I-746)+(2.056)+(5.007), (I-746)+(2.056)+(5.008), (I-746)+(2.056)+(5.009), (I-746)+(2.056)+(5.010), (I-746)+(2.056)+(5.011), (I-746)+(2.056)+(5.012), (I-746)+(2.056)+(5.013), (I-746)+(2.056)+(5.014), (I-746)+(2.056)+(5.015), (I-746)+(2.056)+(5.016), (I-746)+(2.056)+(5.017), (I-746)+(2.056)+(5.018), (I-746)+(2.056)+(5.019), (I-746)+(2.056)+(5.020), (I-746)+(2.056)+(5.021), (I-746)+(2.056)+(5.022), (I-746)+(2.056)+(5.023), (I-746)+(2.056)+(6.001), (I-746)+(2.056)+(6.002), (I-746)+(2.056)+(6.003), (I-746)+(2.056)+(6.004), (I-746)+(2.056)+(7.001), (I-746)+(2.056)+(7.002), (I-746)+(2.056)+(7.003), (I-746)+(2.056)+(7.004), (I-746)+(2.056)+(7.005), (I-746)+(2.056)+(7.006), (I-746)+(2.056)+(9.001), (I-746)+(2.056)+(9.002), (I-746)+(2.056)+(9.003), (I-746)+(2.056)+(9.004), (I-746)+(2.056)+(9.005), (I-746)+(2.056)+(9.006), (I-746)+(2.056)+(9.007), (I-746)+(2.056)+(9.008), (I-746)+(2.056)+(9.009), (I-746)+(2.056)+(14.001), (I-746)+(2.056)+(14.002), (I-746)+(2.056)+(15.008), (I-746)+(2.056)+(15.011), (I-746)+(2.056)+(15.012), (I-746)+(2.056)+(15.016), (I-746)+(2.056)+(15.025), (I-746)+(2.056)+(15.027), (I-746)+(2.056)+(15.047), (I-746)+(2.056)+(15.063), (I-746)+(2.056)+(15.064), (I-746)+(2.056)+(16.001), (I-746)+(2.056)+(16.002), (I-746)+(2.056)+(16.003), (I-746)+(2.056)+(16.004), (I-746)+(2.056)+(16.005), (I-746)+(2.056)+(16.006), (I-746)+(2.056)+(16.007), (I-746)+(2.056)+(16.008), (I-746)+(2.056)+(17.001), (I-746)+(2.056)+(17.002), (I-746)+(2.056)+(17.003), (I-746)+(2.056)+(17.004), (I-746)+(2.056)+(17.005), (I-746)+(2.056)+(17.006), (I-746)+(2.056)+(17.007), (I-746)+(2.056)+(17.008), (I-746)+(2.056)+(17.009), (I-746)+(2.056)+(17.010), (I-746)+(2.056)+(17.011), (I-746)+(2.056)+(17.012), (I-746)+(2.056)+(18.001),

(I-746)+(2.057)+(3.001), (I-746)+(2.057)+(3.002), (I-746)+(2.057)+(3.003), (I-746)+(2.057)+(3.004), (I-746)+(2.057)+(3.005), (I-746)+(2.057)+(3.006), (I-746)+(2.057)+(3.007), (I-746)+(2.057)+(3.008), (I-746)+(2.057)+(3.009), (I-746)+(2.057)+(3.010), (I-746)+(2.057)+(3.011), (I-746)+(2.057)+(3.012), (I-746)+(2.057)+(3.013), (I-746)+(2.057)+(3.014), (I-746)+(2.057)+(3.015), (I-746)+(2.057)+(3.016), (I-746)+(2.057)+(3.017), (I-746)+(2.057)+(3.018), (I-746)+(2.057)+(3.019), (I-746)+(2.057)+(3.020), (I-746)+(2.057)+(3.021), (I-746)+(2.057)+(3.022), (I-746)+(2.057)+(3.023), (I-746)+(2.057)+(3.024), (I-746)+(2.057)+(3.025), (I-746)+(2.057)+(3.026), (I-746)+(2.057)+(3.027), (I-746)+(2.057)+(3.028), (I-746)+(2.057)+(3.029), (I-746)+(2.057)+(3.030), (I-746)+(2.057)+(3.031), (I-746)+(2.057)+(5.001), (I-746)+(2.057)+(5.002), (I-746)+(2.057)+(5.003), (I-746)+(2.057)+(5.004), (I-746)+(2.057)+(5.005), (I-746)+(2.057)+(5.006), (I-746)+(2.057)+(5.007), (I-746)+(2.057)+(5.008), (I-746)+(2.057)+(5.009), (I-746)+(2.057)+(5.010), (I-746)+(2.057)+(5.011), (I-746)+(2.057)+(5.012), (I-746)+(2.057)+(5.013), (I-746)+(2.057)+(5.014), (I-746)+(2.057)+(5.015), (I-746)+(2.057)+(5.016), (I-746)+(2.057)+(5.017), (I-746)+(2.057)+(5.018), (I-746)+(2.057)+(5.019), (I-746)+(2.057)+(5.020), (I-746)+(2.057)+(5.021), (I-746)+(2.057)+(5.022), (I-746)+(2.057)+(5.023), (I-746)+(2.057)+(6.001), (I-746)+(2.057)+(6.002), (I-746)+(2.057)+(6.003), (I-746)+(2.057)+(6.004), (I-746)+(2.057)+(7.001), (I-746)+(2.057)+(7.002), (I-746)+(2.057)+(7.003), (I-746)+(2.057)+(7.004), (I-746)+(2.057)+(7.005), (I-746)+(2.057)+(7.006), (I-746)+(2.057)+(9.001), (I-746)+(2.057)+(9.002), (I-746)+(2.057)+(9.003), (I-746)+(2.057)+(9.004), (I-746)+(2.057)+(9.005), (I-746)+(2.057)+(9.006), (I-746)+(2.057)+(9.007), (I-746)+(2.057)+(9.008), (I-746)+(2.057)+(9.009), (I-746)+(2.057)+(14.001), (I-746)+(2.057)+(14.002), (I-746)+(2.057)+(15.008), (I-746)+(2.057)+(15.011), (I-746)+(2.057)+(15.012), (I-746)+(2.057)+(15.016), (I-746)+(2.057)+(15.025), (I-746)+(2.057)+(15.027), (I-746)+(2.057)+(15.047), (I-746)+(2.057)+(15.063), (I-746)+(2.057)+(15.064), (I-746)+(2.057)+(16.001), (I-746)+(2.057)+(16.002), (I-746)+(2.057)+(16.003), (I-746)+(2.057)+(16.004), (I-746)+(2.057)+(16.005), (I-746)+(2.057)+(16.006), (I-746)+(2.057)+(16.007), (I-746)+(2.057)+(16.008), (I-746)+(2.057)+(17.001), (I-746)+(2.057)+(17.002), (I-746)+(2.057)+(17.003), (I-746)+(2.057)+(17.004), (I-746)+(2.057)+(17.005), (I-746)+(2.057)+(17.006), (I-746)+(2.057)+(17.007), (I-746)+(2.057)+(17.008), (I-746)+(2.057)+(17.009), (I-746)+(2.057)+(17.010), (I-746)+(2.057)+(17.011), (I-746)+(2.057)+(17.012), (I-746)+(2.057)+(18.001),

(I-746)+(2.058)+(3.001), (I-746)+(2.058)+(3.002), (I-746)+(2.058)+(3.003), (I-746)+(2.058)+(3.004), (I-746)+(2.058)+(3.005), (I-746)+(2.058)+(3.006), (I-746)+(2.058)+(3.007), (I-746)+(2.058)+(3.008), (I-746)+(2.058)+(3.009), (I-746)+(2.058)+(3.010), (I-746)+(2.058)+(3.011), (I-746)+(2.058)+(3.012), (I-746)+(2.058)+(3.013), (I-746)+(2.058)+(3.014), (I-746)+(2.058)+(3.015), (I-746)+(2.058)+(3.016), (I-746)+(2.058)+(3.017), (I-746)+(2.058)+(3.018), (I-746)+(2.058)+(3.019), (I-746)+(2.058)+(3.020), (I-746)+(2.058)+(3.021), (I-746)+(2.058)+(3.022), (I-746)+(2.058)+(3.023), (I-746)+(2.058)+(3.024), (I-746)+(2.058)+(3.025), (I-746)+(2.058)+(3.026), (I-746)+(2.058)+(3.027), (I-746)+(2.058)+(3.028), (I-746)+(2.058)+(3.029), (I-746)+(2.058)+(3.030), (I-746)+(2.058)+(3.031), (I-746)+(2.058)+(5.001), (I-746)+(2.058)+(5.002), (I-746)+(2.058)+(5.003), (I-746)+(2.058)+(5.004), (I-746)+(2.058)+(5.005), (I-746)+(2.058)+(5.006), (I-746)+(2.058)+(5.007), (I-746)+(2.058)+(5.008), (I-746)+(2.058)+(5.009), (I-746)+(2.058)+(5.010), (I-746)+(2.058)+(5.011), (I-746)+(2.058)+(5.012), (I-746)+(2.058)+(5.013), (I-746)+(2.058)+(5.014), (I-746)+(2.058)+(5.015), (I-746)+(2.058)+(5.016), (I-746)+(2.058)+(5.017), (I-746)+(2.058)+(5.018), (I-746)+(2.058)+(5.019), (I-746)+(2.058)+(5.020), (I-746)+(2.058)+(5.021), (I-746)+(2.058)+(5.022), (I-746)+(2.058)+(5.023), (I-746)+(2.058)+(6.001), (I-746)+(2.058)+(6.002), (I-746)+(2.058)+(6.003), (I-746)+(2.058)+(6.004), (I-746)+(2.058)+(7.001), (I-746)+(2.058)+(7.002), (I-746)+(2.058)+(7.003), (I-746)+(2.058)+(7.004), (I-746)+(2.058)+(7.005), (I-746)+(2.058)+(7.006), (I-746)+(2.058)+(9.001), (I-746)+(2.058)+(9.002), (I-746)+(2.058)+(9.003), (I-746)+(2.058)+(9.004), (I-746)+(2.058)+(9.005), (I-746)+(2.058)+(9.006), (I-746)+(2.058)+(9.007), (I-746)+(2.058)+(9.008), (I-746)+(2.058)+(9.009), (I-746)+(2.058)+(14.001), (I-746)+(2.058)+(14.002), (I-746)+(2.058)+(15.008), (I-746)+(2.058)+(15.011), (I-746)+(2.058)+(15.012), (I-746)+(2.058)+(15.016), (I-746)+(2.058)+(15.025), (I-746)+(2.058)+(15.027), (I-746)+(2.058)+(15.047), (I-746)+(2.058)+(15.063), (I-746)+(2.058)+(15.064), (I-746)+(2.058)+(16.001), (I-746)+(2.058)+(16.002), (I-746)+(2.058)+(16.003), (I-746)+(2.058)+(16.004), (I-746)+(2.058)+(16.005), (I-746)+(2.058)+(16.006), (I-746)+(2.058)+(16.007), (I-746)+(2.058)+(16.008), (I-746)+(2.058)+(17.001), (I-746)+(2.058)+(17.002), (I-746)+(2.058)+(17.003), (I-746)+(2.058)+(17.004), (I-746)+(2.058)+(17.005), (I-746)+(2.058)+(17.006), (I-746)+(2.058)+(17.007), (I-746)+(2.058)+(17.008), (I-746)+(2.058)+(17.009), (I-746)+(2.058)+(17.010), (I-746)+(2.058)+(17.011), (I-746)+(2.058)+(17.012), (I-746)+(2.058)+(18.001),

(I-746)+(2.059)+(3.001), (I-746)+(2.059)+(3.002), (I-746)+(2.059)+(3.003), (I-746)+(2.059)+(3.004), (I-746)+(2.059)+(3.005), (I-746)+(2.059)+(3.006), (I-746)+(2.059)+(3.007), (I-746)+(2.059)+(3.008), (I-746)+(2.059)+(3.009), (I-746)+(2.059)+(3.010), (I-746)+(2.059)+(3.011), (I-746)+(2.059)+(3.012), (I-746)+(2.059)+(3.013), (I-746)+(2.059)+(3.014), (I-746)+(2.059)+(3.015), (I-746)+(2.059)+(3.016), (I-746)+(2.059)+(3.017), (I-746)+(2.059)+(3.018), (I-746)+(2.059)+(3.019), (I-746)+(2.059)+(3.020), (I-746)+(2.059)+(3.021), (I-746)+(2.059)+(3.022), (I-746)+(2.059)+(3.023), (I-746)+(2.059)+(3.024), (I-746)+(2.059)+(3.025), (I-746)+(2.059)+(3.026), (I-746)+(2.059)+(3.027), (I-746)+(2.059)+(3.028), (I-746)+(2.059)+(3.029), (I-746)+(2.059)+(3.030), (I-746)+(2.059)+(3.031), (I-746)+(2.059)+(5.001), (I-746)+(2.059)+(5.002), (I-746)+(2.059)+(5.003), (I-746)+(2.059)+(5.004), (I-746)+(2.059)+(5.005), (I-746)+(2.059)+(5.006), (I-746)+(2.059)+(5.007), (I-746)+(2.059)+(5.008), (I-746)+(2.059)+(5.009), (I-746)+(2.059)+(5.010), (I-746)+(2.059)+(5.011), (I-746)+(2.059)+(5.012), (I-746)+(2.059)+(5.013), (I-746)+(2.059)+(5.014), (I-746)+(2.059)+(5.015), (I-746)+(2.059)+(5.016), (I-746)+(2.059)+(5.017), (I-746)+(2.059)+(5.018), (I-746)+(2.059)+(5.019), (I-746)+(2.059)+(5.020), (I-746)+(2.059)+(5.021), (I-746)+(2.059)+(5.022), (I-746)+(2.059)+(5.023), (I-746)+(2.059)+(6.001), (I-746)+(2.059)+(6.002), (I-746)+(2.059)+(6.003), (I-746)+(2.059)+(6.004), (I-746)+(2.059)+(7.001), (I-746)+(2.059)+(7.002), (I-746)+(2.059)+(7.003), (I-746)+(2.059)+(7.004), (I-746)+(2.059)+(7.005), (I-746)+(2.059)+(7.006), (I-746)+(2.059)+(9.001), (I-746)+(2.059)+(9.002), (I-746)+(2.059)+(9.003), (I-746)+(2.059)+(9.004), (I-746)+(2.059)+(9.005), (I-746)+(2.059)+(9.006), (I-746)+(2.059)+(9.007), (I-746)+(2.059)+(9.008), (I-746)+(2.059)+(9.009), (I-746)+(2.059)+(14.001), (I-746)+(2.059)+(14.002), (I-746)+(2.059)+(15.008), (I-746)+(2.059)+(15.011), (I-746)+(2.059)+(15.012), (I-746)+(2.059)+(15.016), (I-746)+(2.059)+(15.025), (I-746)+(2.059)+(15.027), (I-746)+(2.059)+(15.047), (I-746)+(2.059)+(15.063), (I-746)+(2.059)+(15.064), (I-746)+(2.059)+(16.001), (I-746)+(2.059)+(16.002), (I-746)+(2.059)+(16.003), (I-746)+(2.059)+(16.004), (I-746)+(2.059)+(16.005), (I-746)+(2.059)+(16.006), (I-746)+(2.059)+(16.007), (I-746)+(2.059)+(16.008), (I-746)+(2.059)+(17.001), (I-746)+(2.059)+(17.002), (I-746)+(2.059)+(17.003), (I-746)+(2.059)+(17.004), (I-746)+(2.059)+(17.005), (I-746)+(2.059)+(17.006), (I-746)+(2.059)+(17.007), (I-746)+(2.059)+(17.008), (I-746)+(2.059)+(17.009), (I-746)+(2.059)+(17.010), (I-746)+(2.059)+(17.011), (I-746)+(2.059)+(17.012), (I-746)+(2.059)+(18.001),

(I-746)+(3.001)+(3.025), (I-746)+(3.001)+(3.030), (I-746)+(3.001)+(3.031), (I-746)+(3.001)+(5.001), (I-746)+(3.001)+(5.002), (I-746)+(3.001)+(5.003), (I-746)+(3.001)+(5.004), (I-746)+(3.001)+(5.005), (I-746)+(3.001)+(5.006), (I-746)+(3.001)+(5.007), (I-746)+(3.001)+(5.008), (I-746)+(3.001)+(5.009), (I-746)+(3.001)+(5.010), (I-746)+(3.001)+(5.011), (I-746)+(3.001)+(5.012), (I-746)+(3.001)+(5.013), (I-746)+(3.001)+(5.014), (I-746)+(3.001)+(5.015), (I-746)+(3.001)+(5.016), (I-746)+(3.001)+(5.017), (I-746)+(3.001)+(5.018), (I-746)+(3.001)+(5.019), (I-746)+(3.001)+(5.020), (I-746)+(3.001)+(5.021), (I-746)+(3.001)+(5.022), (I-746)+(3.001)+(5.023), (I-746)+(3.001)+(6.001), (I-746)+(3.001)+(6.002), (I-746)+(3.001)+(6.003), (I-746)+(3.001)+(6.004), (I-746)+(3.001)+(7.001), (I-746)+(3.001)+(7.002), (I-746)+(3.001)+(7.003), (I-746)+(3.001)+(7.004), (I-746)+(3.001)+(7.005), (I-746)+(3.001)+(7.006), (I-746)+(3.001)+(9.001), (I-746)+(3.001)+(9.002), (I-746)+(3.001)+(9.003), (I-746)+(3.001)+(9.004), (I-746)+(3.001)+(9.005), (I-746)+(3.001)+(9.006), (I-746)+(3.001)+(9.007), (I-746)+(3.001)+(9.008), (I-746)+(3.001)+(9.009), (I-746)+(3.001)+(14.001), (I-746)+(3.001)+(14.002), (I-746)+(3.001)+(15.008), (I-746)+(3.001)+(15.011), (I-746)+(3.001)+(15.012), (I-746)+(3.001)+(15.016), (I-746)+(3.001)+(15.025), (I-746)+(3.001)+(15.027), (I-746)+(3.001)+(15.047), (I-746)+(3.001)+(15.063), (I-746)+(3.001)+(15.064), (I-746)+(3.001)+(16.001), (I-746)+(3.001)+(16.002), (I-746)+(3.001)+(16.003), (I-746)+(3.001)+(16.004), (I-746)+(3.001)+(16.005), (I-746)+(3.001)+(16.006), (I-746)+(3.001)+(16.007), (I-746)+(3.001)+(16.008), (I-746)+(3.001)+(17.001), (I-746)+(3.001)+(17.002), (I-746)+(3.001)+(17.003), (I-746)+(3.001)+(17.004), (I-746)+(3.001)+(17.005), (I-746)+(3.001)+(17.006), (I-746)+(3.001)+(17.007), (I-746)+(3.001)+(17.008), (I-746)+(3.001)+(17.009), (I-746)+(3.001)+(17.010), (I-746)+(3.001)+(17.011), (I-746)+(3.001)+(17.012), (I-746)+(3.001)+(18.001),

(I-746)+(3.002)+(3.025), (I-746)+(3.002)+(3.030), (I-746)+(3.002)+(3.031), (I-746)+(3.002)+(5.001), (I-746)+(3.002)+(5.002), (I-746)+(3.002)+(5.003), (I-746)+(3.002)+(5.004), (I-746)+(3.002)+(5.005), (I-746)+(3.002)+(5.006), (I-746)+(3.002)+(5.007), (I-746)+(3.002)+(5.008), (I-746)+(3.002)+(5.009), (I-746)+(3.002)+(5.010), (I-746)+(3.002)+(5.011), (I-746)+(3.002)+(5.012), (I-746)+(3.002)+(5.013), (I-746)+(3.002)+(5.014), (I-746)+(3.002)+(5.015), (I-746)+(3.002)+(5.016), (I-746)+(3.002)+(5.017), (I-746)+(3.002)+(5.018), (I-746)+(3.002)+(5.019), (I-746)+(3.002)+(5.020), (I-746)+(3.002)+(5.021), (I-746)+(3.002)+(5.022), (I-746)+(3.002)+(5.023), (I-746)+(3.002)+(6.001), (I-746)+(3.002)+(6.002), (I-746)+(3.002)+(6.003), (I-746)+(3.002)+(6.004), (I-746)+(3.002)+(7.001), (I-746)+(3.002)+(7.002), (I-746)+(3.002)+(7.003), (I-746)+(3.002)+(7.004), (I-746)+(3.002)+(7.005), (I-746)+(3.002)+(7.006), (I-746)+(3.002)+(9.001), (I-746)+(3.002)+(9.002), (I-746)+(3.002)+(9.003), (I-746)+(3.002)+(9.004), (I-746)+(3.002)+(9.005), (I-746)+(3.002)+(9.006), (I-746)+(3.002)+(9.007), (I-746)+(3.002)+(9.008), (I-746)+(3.002)+(9.009), (I-746)+(3.002)+(14.001), (I-746)+(3.002)+(14.002), (I-746)+(3.002)+(15.008), (I-746)+(3.002)+(15.011), (I-746)+(3.002)+(15.012), (I-746)+(3.002)+(15.016), (I-746)+(3.002)+(15.025), (I-746)+(3.002)+(15.027), (I-746)+(3.002)+(15.047), (I-746)+(3.002)+(15.063), (I-746)+(3.002)+(15.064), (I-746)+(3.002)+(16.001), (I-746)+(3.002)+(16.002), (I-746)+(3.002)+(16.003), (I-746)+(3.002)+(16.004), (I-746)+(3.002)+(16.005), (I-746)+(3.002)+(16.006), (I-746)+(3.002)+(16.007), (I-746)+(3.002)+(16.008), (I-746)+(3.002)+(17.001), (I-746)+(3.002)+(17.002), (I-746)+(3.002)+(17.003), (I-746)+(3.002)+(17.004), (I-746)+(3.002)+(17.005), (I-746)+(3.002)+(17.006), (I-746)+(3.002)+(17.007), (I-746)+(3.002)+(17.008), (I-746)+(3.002)+(17.009), (I-746)+(3.002)+(17.010), (I-746)+(3.002)+(17.011), (I-746)+(3.002)+(17.012), (I-746)+(3.002)+(18.001),

(I-746)+(3.003)+(3.025), (I-746)+(3.003)+(3.030), (I-746)+(3.003)+(3.031), (I-746)+(3.003)+(5.001), (I-746)+(3.003)+(5.002), (I-746)+(3.003)+(5.003), (I-746)+(3.003)+(5.004), (I-746)+(3.003)+(5.005), (I-746)+(3.003)+(5.006), (I-746)+(3.003)+(5.007), (I-746)+(3.003)+(5.008), (I-746)+(3.003)+(5.009), (I-746)+(3.003)+(5.010), (I-746)+(3.003)+(5.011), (I-746)+(3.003)+(5.012), (I-746)+(3.003)+(5.013), (I-746)+(3.003)+(5.014), (I-746)+(3.003)+(5.015), (I-746)+(3.003)+(5.016), (I-746)+(3.003)+(5.017), (I-746)+(3.003)+(5.018), (I-746)+(3.003)+(5.019), (I-746)+(3.003)+(5.020), (I-746)+(3.003)+(5.021), (I-746)+(3.003)+(5.022), (I-746)+(3.003)+(5.023), (I-746)+(3.003)+(6.001), (I-746)+(3.003)+(6.002), (I-746)+(3.003)+(6.003), (I-746)+(3.003)+(6.004), (I-746)+(3.003)+(7.001), (I-746)+(3.003)+(7.002), (I-746)+(3.003)+(7.003), (I-746)+(3.003)+(7.004), (I-746)+(3.003)+(7.005), (I-746)+(3.003)+(7.006), (I-746)+(3.003)+(9.001), (I-746)+(3.003)+(9.002), (I-746)+(3.003)+(9.003), (I-746)+(3.003)+(9.004), (I-746)+(3.003)+(9.005), (I-746)+(3.003)+(9.006), (I-746)+(3.003)+(9.007), (I-746)+(3.003)+(9.008), (I-746)+(3.003)+(9.009), (I-746)+(3.003)+(14.001), (I-746)+(3.003)+(14.002), (I-746)+(3.003)+(15.008), (I-746)+(3.003)+(15.011), (I-746)+(3.003)+(15.012), (I-746)+(3.003)+(15.016), (I-746)+(3.003)+(15.025), (I-746)+(3.003)+(15.027), (I-746)+(3.003)+(15.047), (I-746)+(3.003)+(15.063), (I-746)+(3.003)+(15.064), (I-746)+(3.003)+(16.001), (I-746)+(3.003)+(16.002), (I-746)+(3.003)+(16.003), (I-746)+(3.003)+(16.004), (I-746)+(3.003)+(16.005), (I-746)+(3.003)+(16.006), (I-746)+(3.003)+(16.007), (I-746)+(3.003)+(16.008), (I-746)+(3.003)+(17.001), (I-746)+(3.003)+(17.002), (I-746)+(3.003)+(17.003), (I-746)+(3.003)+(17.004), (I-746)+(3.003)+(17.005), (I-746)+(3.003)+(17.006), (I-746)+(3.003)+(17.007), (I-746)+(3.003)+(17.008), (I-746)+(3.003)+(17.009), (I-746)+(3.003)+(17.010), (I-746)+(3.003)+(17.011), (I-746)+(3.003)+(17.012), (I-746)+(3.003)+(18.001),

(I-746)+(3.004)+(3.025), (I-746)+(3.004)+(3.030), (I-746)+(3.004)+(3.031), (I-746)+(3.004)+(5.001), (I-746)+(3.004)+(5.002), (I-746)+(3.004)+(5.003), (I-746)+(3.004)+(5.004), (I-746)+(3.004)+(5.005), (I-746)+(3.004)+(5.006), (I-746)+(3.004)+(5.007), (I-746)+(3.004)+(5.008), (I-746)+(3.004)+(5.009), (I-746)+(3.004)+(5.010), (I-746)+(3.004)+(5.011), (I-746)+(3.004)+(5.012), (I-746)+(3.004)+(5.013), (I-746)+(3.004)+(5.014), (I-746)+(3.004)+(5.015), (I-746)+(3.004)+(5.016), (I-746)+(3.004)+(5.017), (I-746)+(3.004)+(5.018), (I-746)+(3.004)+(5.019), (I-746)+(3.004)+(5.020), (I-746)+(3.004)+(5.021), (I-746)+(3.004)+(5.022), (I-746)+(3.004)+(5.023), (I-746)+(3.004)+(6.001), (I-746)+(3.004)+(6.002), (I-746)+(3.004)+(6.003), (I-746)+(3.004)+(6.004), (I-746)+(3.004)+(7.001), (I-746)+(3.004)+(7.002), (I-746)+(3.004)+(7.003), (I-746)+(3.004)+(7.004), (I-746)+(3.004)+(7.005), (I-746)+(3.004)+(7.006), (I-746)+(3.004)+(9.001), (I-746)+(3.004)+(9.002), (I-746)+(3.004)+(9.003), (I-746)+(3.004)+(9.004), (I-746)+(3.004)+(9.005), (I-746)+(3.004)+(9.006), (I-746)+(3.004)+(9.007), (I-746)+(3.004)+(9.008), (I-746)+(3.004)+(9.009), (I-746)+(3.004)+(14.001), (I-746)+(3.004)+(14.002), (I-746)+(3.004)+(15.008), (I-746)+(3.004)+(15.011), (I-746)+(3.004)+(15.012), (I-746)+(3.004)+(15.016), (I-746)+(3.004)+(15.025), (I-746)+(3.004)+(15.027), (I-746)+(3.004)+(15.047), (I-746)+(3.004)+(15.063), (I-746)+(3.004)+(15.064), (I-746)+(3.004)+(16.001), (I-746)+(3.004)+(16.002), (I-746)+(3.004)+(16.003), (I-746)+(3.004)+(16.004), (I-746)+(3.004)+(16.005), (I-746)+(3.004)+(16.006), (I-746)+(3.004)+(16.007), (I-746)+(3.004)+(16.008), (I-746)+(3.004)+(17.001), (I-746)+(3.004)+(17.002), (I-746)+(3.004)+(17.003), (I-746)+(3.004)+(17.004), (I-746)+(3.004)+(17.005), (I-746)+(3.004)+(17.006), (I-746)+(3.004)+(17.007), (I-746)+(3.004)+(17.008), (I-746)+(3.004)+(17.009), (I-746)+(3.004)+(17.010), (I-746)+(3.004)+(17.011), (I-746)+(3.004)+(17.012), (I-746)+(3.004)+(18.001),

(I-746)+(3.005)+(3.025), (I-746)+(3.005)+(3.030), (I-746)+(3.005)+(3.031), (I-746)+(3.005)+(5.001), (I-746)+(3.005)+(5.002), (I-746)+(3.005)+(5.003), (I-746)+(3.005)+(5.004), (I-746)+(3.005)+(5.005), (I-746)+(3.005)+(5.006), (I-746)+(3.005)+(5.007), (I-746)+(3.005)+(5.008), (I-746)+(3.005)+(5.009), (I-746)+(3.005)+(5.010), (I-746)+(3.005)+(5.011), (I-746)+(3.005)+(5.012), (I-746)+(3.005)+(5.013), (I-746)+(3.005)+(5.014), (I-746)+(3.005)+(5.015), (I-746)+(3.005)+(5.016), (I-746)+(3.005)+(5.017), (I-746)+(3.005)+(5.018), (I-746)+(3.005)+(5.019), (I-746)+(3.005)+(5.020), (I-746)+(3.005)+(5.021), (I-746)+(3.005)+(5.022), (I-746)+(3.005)+(5.023), (I-746)+(3.005)+(6.001), (I-746)+(3.005)+(6.002), (I-746)+(3.005)+(6.003), (I-746)+(3.005)+(6.004), (I-746)+(3.005)+(7.001), (I-746)+(3.005)+(7.002), (I-746)+(3.005)+(7.003), (I-746)+(3.005)+(7.004), (I-746)+(3.005)+(7.005), (I-746)+(3.005)+(7.006), (I-746)+(3.005)+(9.001), (I-746)+(3.005)+(9.002), (I-746)+(3.005)+(9.003), (I-746)+(3.005)+(9.004), (I-746)+(3.005)+(9.005), (I-746)+(3.005)+(9.006), (I-746)+(3.005)+(9.007), (I-746)+(3.005)+(9.008), (I-746)+(3.005)+(9.009), (I-746)+(3.005)+(14.001), (I-746)+(3.005)+(14.002), (I-746)+(3.005)+(15.008), (I-746)+(3.005)+(15.011), (I-746)+(3.005)+(15.012), (I-746)+(3.005)+(15.016), (I-746)+(3.005)+(15.025), (I-746)+(3.005)+(15.027), (I-746)+(3.005)+(15.047), (I-746)+(3.005)+(15.063), (I-746)+(3.005)+(15.064), (I-746)+(3.005)+(16.001), (I-746)+(3.005)+(16.002), (I-746)+(3.005)+(16.003), (I-746)+(3.005)+(16.004), (I-746)+(3.005)+(16.005), (I-746)+(3.005)+(16.006), (I-746)+(3.005)+(16.007), (I-746)+(3.005)+(16.008), (I-746)+(3.005)+(17.001), (I-746)+(3.005)+(17.002), (I-746)+(3.005)+(17.003), (I-746)+(3.005)+(17.004), (I-746)+(3.005)+(17.005), (I-746)+(3.005)+(17.006), (I-746)+(3.005)+(17.007), (I-746)+(3.005)+(17.008), (I-746)+(3.005)+(17.009), (I-746)+(3.005)+(17.010), (I-746)+(3.005)+(17.011), (I-746)+(3.005)+(17.012), (I-746)+(3.005)+(18.001),

(I-746)+(3.006)+(3.025), (I-746)+(3.006)+(3.030), (I-746)+(3.006)+(3.031), (I-746)+(3.006)+(5.001), (I-746)+(3.006)+(5.002), (I-746)+(3.006)+(5.003), (I-746)+(3.006)+(5.004), (I-746)+(3.006)+(5.005), (I-746)+(3.006)+(5.006), (I-746)+(3.006)+(5.007), (I-746)+(3.006)+(5.008), (I-746)+(3.006)+(5.009), (I-746)+(3.006)+(5.010), (I-746)+(3.006)+(5.011), (I-746)+(3.006)+(5.012), (I-746)+(3.006)+(5.013), (I-746)+(3.006)+(5.014), (I-746)+(3.006)+(5.015), (I-746)+(3.006)+(5.016), (I-746)+(3.006)+(5.017), (I-746)+(3.006)+(5.018), (I-746)+(3.006)+(5.019), (I-746)+(3.006)+(5.020), (I-746)+(3.006)+(5.021), (I-746)+(3.006)+(5.022), (I-746)+(3.006)+(5.023), (I-746)+(3.006)+(6.001), (I-746)+(3.006)+(6.002), (I-746)+(3.006)+(6.003), (I-746)+(3.006)+(6.004), (I-746)+(3.006)+(7.001), (I-746)+(3.006)+(7.002), (I-746)+(3.006)+(7.003), (I-746)+(3.006)+(7.004), (I-746)+(3.006)+(7.005), (I-746)+(3.006)+(7.006), (I-746)+(3.006)+(9.001), (I-746)+(3.006)+(9.002), (I-746)+(3.006)+(9.003), (I-746)+(3.006)+(9.004), (I-746)+(3.006)+(9.005), (I-746)+(3.006)+(9.006), (I-746)+(3.006)+(9.007), (I-746)+(3.006)+(9.008), (I-746)+(3.006)+(9.009), (I-746)+(3.006)+(14.001), (I-746)+(3.006)+(14.002), (I-746)+(3.006)+(15.008), (I-746)+(3.006)+(15.011), (I-746)+(3.006)+(15.012), (I-746)+(3.006)+(15.016), (I-746)+(3.006)+(15.025), (I-746)+(3.006)+(15.027), (I-746)+(3.006)+(15.047), (I-746)+(3.006)+(15.063), (I-746)+(3.006)+(15.064), (I-746)+(3.006)+(16.001), (I-746)+(3.006)+(16.002), (I-746)+(3.006)+(16.003), (I-746)+(3.006)+(16.004), (I-746)+(3.006)+(16.005), (I-746)+(3.006)+(16.006), (I-746)+(3.006)+(16.007), (I-746)+(3.006)+(16.008), (I-746)+(3.006)+(17.001), (I-746)+(3.006)+(17.002), (I-746)+(3.006)+(17.003), (I-746)+(3.006)+(17.004), (I-746)+(3.006)+(17.005), (I-746)+(3.006)+(17.006), (I-746)+(3.006)+(17.007), (I-746)+(3.006)+(17.008), (I-746)+(3.006)+(17.009), (I-746)+(3.006)+(17.010), (I-746)+(3.006)+(17.011), (I-746)+(3.006)+(17.012), (I-746)+(3.006)+(18.001),

(I-746)+(3.007)+(3.025), (I-746)+(3.007)+(3.030), (I-746)+(3.007)+(3.031), (I-746)+(3.007)+(5.001), (I-746)+(3.007)+(5.002), (I-746)+(3.007)+(5.003), (I-746)+(3.007)+(5.004), (I-746)+(3.007)+(5.005), (I-746)+(3.007)+(5.006), (I-746)+(3.007)+(5.007), (I-746)+(3.007)+(5.008), (I-746)+(3.007)+(5.009), (I-746)+(3.007)+(5.010), (I-746)+(3.007)+(5.011), (I-746)+(3.007)+(5.012), (I-746)+(3.007)+(5.013), (I-746)+(3.007)+(5.014), (I-746)+(3.007)+(5.015), (I-746)+(3.007)+(5.016), (I-746)+(3.007)+(5.017), (I-746)+(3.007)+(5.018), (I-746)+(3.007)+(5.019), (I-746)+(3.007)+(5.020), (I-746)+(3.007)+(5.021), (I-746)+(3.007)+(5.022), (I-746)+(3.007)+(5.023), (I-746)+(3.007)+(6.001), (I-746)+(3.007)+(6.002), (I-746)+(3.007)+(6.003), (I-746)+(3.007)+(6.004), (I-746)+(3.007)+(7.001), (I-746)+(3.007)+(7.002), (I-746)+(3.007)+(7.003), (I-746)+(3.007)+(7.004), (I-746)+(3.007)+(7.005), (I-746)+(3.007)+(7.006), (I-746)+(3.007)+(9.001), (I-746)+(3.007)+(9.002), (I-746)+(3.007)+(9.003), (I-746)+(3.007)+(9.004), (I-746)+(3.007)+(9.005), (I-746)+(3.007)+(9.006), (I-746)+(3.007)+(9.007), (I-746)+(3.007)+(9.008), (I-746)+(3.007)+(9.009), (I-746)+(3.007)+(14.001), (I-746)+(3.007)+(14.002), (I-746)+(3.007)+(15.008), (I-746)+(3.007)+(15.011), (I-746)+(3.007)+(15.012), (I-746)+(3.007)+(15.016), (I-746)+(3.007)+(15.025), (I-746)+(3.007)+(15.027), (I-746)+(3.007)+(15.047), (I-746)+(3.007)+(15.063), (I-746)+(3.007)+(15.064), (I-746)+(3.007)+(16.001), (I-746)+(3.007)+(16.002), (I-746)+(3.007)+(16.003), (I-746)+(3.007)+(16.004), (I-746)+(3.007)+(16.005), (I-746)+(3.007)+(16.006), (I-746)+(3.007)+(16.007), (I-746)+(3.007)+(16.008), (I-746)+(3.007)+(17.001), (I-746)+(3.007)+(17.002), (I-746)+(3.007)+(17.003), (I-746)+(3.007)+(17.004), (I-746)+(3.007)+(17.005), (I-746)+(3.007)+(17.006), (I-746)+(3.007)+(17.007), (I-746)+(3.007)+(17.008), (I-746)+(3.007)+(17.009), (I-746)+(3.007)+(17.010), (I-746)+(3.007)+(17.011), (I-746)+(3.007)+(17.012), (I-746)+(3.007)+(18.001),

(I-746)+(3.008)+(3.025), (I-746)+(3.008)+(3.030), (I-746)+(3.008)+(3.031), (I-746)+(3.008)+(5.001), (I-746)+(3.008)+(5.002), (I-746)+(3.008)+(5.003), (I-746)+(3.008)+(5.004), (I-746)+(3.008)+(5.005), (I-746)+(3.008)+(5.006), (I-746)+(3.008)+(5.007), (I-746)+(3.008)+(5.008), (I-746)+(3.008)+(5.009), (I-746)+(3.008)+(5.010), (I-746)+(3.008)+(5.011), (I-746)+(3.008)+(5.012), (I-746)+(3.008)+(5.013), (I-746)+(3.008)+(5.014), (I-746)+(3.008)+(5.015), (I-746)+(3.008)+(5.016), (I-746)+(3.008)+(5.017), (I-746)+(3.008)+(5.018), (I-746)+(3.008)+(5.019), (I-746)+(3.008)+(5.020), (I-746)+(3.008)+(5.021), (I-746)+(3.008)+(5.022), (I-746)+(3.008)+(5.023), (I-746)+(3.008)+(6.001), (I-746)+(3.008)+(6.002), (I-746)+(3.008)+(6.003), (I-746)+(3.008)+(6.004), (I-746)+(3.008)+(7.001), (I-746)+(3.008)+(7.002), (I-746)+(3.008)+(7.003), (I-746)+(3.008)+(7.004), (I-746)+(3.008)+(7.005), (I-746)+(3.008)+(7.006), (I-746)+(3.008)+(9.001), (I-746)+(3.008)+(9.002), (I-746)+(3.008)+(9.003), (I-746)+(3.008)+(9.004), (I-746)+(3.008)+(9.005), (I-746)+(3.008)+(9.006), (I-746)+(3.008)+(9.007), (I-746)+(3.008)+(9.008), (I-746)+(3.008)+(9.009), (I-746)+(3.008)+(14.001), (I-746)+(3.008)+(14.002), (I-746)+(3.008)+(15.008), (I-746)+(3.008)+(15.011), (I-746)+(3.008)+(15.012), (I-746)+(3.008)+(15.016), (I-746)+(3.008)+(15.025), (I-746)+(3.008)+(15.027), (I-746)+(3.008)+(15.047), (I-746)+(3.008)+(15.063), (I-746)+(3.008)+(15.064), (I-746)+(3.008)+(16.001), (I-746)+(3.008)+(16.002), (I-746)+(3.008)+(16.003), (I-746)+(3.008)+(16.004), (I-746)+(3.008)+(16.005), (I-746)+(3.008)+(16.006), (I-746)+(3.008)+(16.007), (I-746)+(3.008)+(16.008), (I-746)+(3.008)+(17.001), (I-746)+(3.008)+(17.002), (I-746)+(3.008)+(17.003), (I-746)+(3.008)+(17.004), (I-746)+(3.008)+(17.005), (I-746)+(3.008)+(17.006), (I-746)+(3.008)+(17.007), (I-746)+(3.008)+(17.008), (I-746)+(3.008)+(17.009), (I-746)+(3.008)+(17.010), (I-746)+(3.008)+(17.011), (I-746)+(3.008)+(17.012), (I-746)+(3.008)+(18.001),

(I-746)+(3.009)+(3.025), (I-746)+(3.009)+(3.030), (I-746)+(3.009)+(3.031), (I-746)+(3.009)+(5.001), (I-746)+(3.009)+(5.002), (I-746)+(3.009)+(5.003), (I-746)+(3.009)+(5.004), (I-746)+(3.009)+(5.005), (I-746)+(3.009)+(5.006), (I-746)+(3.009)+(5.007), (I-746)+(3.009)+(5.008), (I-746)+(3.009)+(5.009), (I-746)+(3.009)+(5.010), (I-746)+(3.009)+(5.011), (I-746)+(3.009)+(5.012), (I-746)+(3.009)+(5.013), (I-746)+(3.009)+(5.014), (I-746)+(3.009)+(5.015), (I-746)+(3.009)+(5.016), (I-746)+(3.009)+(5.017), (I-746)+(3.009)+(5.018), (I-746)+(3.009)+(5.019), (I-746)+(3.009)+(5.020), (I-746)+(3.009)+(5.021), (I-746)+(3.009)+(5.022), (I-746)+(3.009)+(5.023), (I-746)+(3.009)+(6.001), (I-746)+(3.009)+(6.002), (I-746)+(3.009)+(6.003), (I-746)+(3.009)+(6.004), (I-746)+(3.009)+(7.001), (I-746)+(3.009)+(7.002), (I-746)+(3.009)+(7.003), (I-746)+(3.009)+(7.004), (I-746)+(3.009)+(7.005), (I-746)+(3.009)+(7.006), (I-746)+(3.009)+(9.001), (I-746)+(3.009)+(9.002), (I-746)+(3.009)+(9.003), (I-746)+(3.009)+(9.004), (I-746)+(3.009)+(9.005), (I-746)+(3.009)+(9.006), (I-746)+(3.009)+(9.007), (I-746)+(3.009)+(9.008), (I-746)+(3.009)+(9.009), (I-746)+(3.009)+(14.001), (I-746)+(3.009)+(14.002), (I-746)+(3.009)+(15.008), (I-746)+(3.009)+(15.011), (I-746)+(3.009)+(15.012), (I-746)+(3.009)+(15.016), (I-746)+(3.009)+(15.025), (I-746)+(3.009)+(15.027), (I-746)+(3.009)+(15.047), (I-746)+(3.009)+(15.063), (I-746)+(3.009)+(15.064), (I-746)+(3.009)+(16.001), (I-746)+(3.009)+(16.002), (I-746)+(3.009)+(16.003), (I-746)+(3.009)+(16.004), (I-746)+(3.009)+(16.005), (I-746)+(3.009)+(16.006), (I-746)+(3.009)+(16.007), (I-746)+(3.009)+(16.008), (I-746)+(3.009)+(17.001), (I-746)+(3.009)+(17.002), (I-746)+(3.009)+(17.003), (I-746)+(3.009)+(17.004), (I-746)+(3.009)+(17.005), (I-746)+(3.009)+(17.006), (I-746)+(3.009)+(17.007), (I-746)+(3.009)+(17.008), (I-746)+(3.009)+(17.009), (I-746)+(3.009)+(17.010), (I-746)+(3.009)+(17.011), (I-746)+(3.009)+(17.012), (I-746)+(3.009)+(18.001),

(I-746)+(3.010)+(3.025), (I-746)+(3.010)+(3.030), (I-746)+(3.010)+(3.031), (I-746)+(3.010)+(5.001), (I-746)+(3.010)+(5.002), (I-746)+(3.010)+(5.003), (I-746)+(3.010)+(5.004), (I-746)+(3.010)+(5.005), (I-746)+(3.010)+(5.006), (I-746)+(3.010)+(5.007), (I-746)+(3.010)+(5.008), (I-746)+(3.010)+(5.009), (I-746)+(3.010)+(5.010), (I-746)+(3.010)+(5.011), (I-746)+(3.010)+(5.012), (I-746)+(3.010)+(5.013), (I-746)+(3.010)+(5.014), (I-746)+(3.010)+(5.015), (I-746)+(3.010)+(5.016), (I-746)+(3.010)+(5.017), (I-746)+(3.010)+(5.018), (I-746)+(3.010)+(5.019), (I-746)+(3.010)+(5.020), (I-746)+(3.010)+(5.021), (I-746)+(3.010)+(5.022), (I-746)+(3.010)+(5.023), (I-746)+(3.010)+(6.001), (I-746)+(3.010)+(6.002), (I-746)+(3.010)+(6.003), (I-746)+(3.010)+(6.004), (I-746)+(3.010)+(7.001), (I-746)+(3.010)+(7.002), (I-746)+(3.010)+(7.003), (I-746)+(3.010)+(7.004), (I-746)+(3.010)+(7.005), (I-746)+(3.010)+(7.006), (I-746)+(3.010)+(9.001), (I-746)+(3.010)+(9.002), (I-746)+(3.010)+(9.003), (I-746)+(3.010)+(9.004), (I-746)+(3.010)+(9.005), (I-746)+(3.010)+(9.006), (I-746)+(3.010)+(9.007), (I-746)+(3.010)+(9.008), (I-746)+(3.010)+(9.009), (I-746)+(3.010)+(14.001), (I-746)+(3.010)+(14.002), (I-746)+(3.010)+(15.008), (I-746)+(3.010)+(15.011), (I-746)+(3.010)+(15.012), (I-746)+(3.010)+(15.016), (I-746)+(3.010)+(15.025), (I-746)+(3.010)+(15.027), (I-746)+(3.010)+(15.047), (I-746)+(3.010)+(15.063), (I-746)+(3.010)+(15.064), (I-746)+(3.010)+(16.001), (I-746)+(3.010)+(16.002), (I-746)+(3.010)+(16.003), (I-746)+(3.010)+(16.004), (I-746)+(3.010)+(16.005), (I-746)+(3.010)+(16.006), (I-746)+(3.010)+(16.007), (I-746)+(3.010)+(16.008), (I-746)+(3.010)+(17.001), (I-746)+(3.010)+(17.002), (I-746)+(3.010)+(17.003), (I-746)+(3.010)+(17.004), (I-746)+(3.010)+(17.005), (I-746)+(3.010)+(17.006), (I-746)+(3.010)+(17.007), (I-746)+(3.010)+(17.008), (I-746)+(3.010)+(17.009), (I-746)+(3.010)+(17.010), (I-746)+(3.010)+(17.011), (I-746)+(3.010)+(17.012), (I-746)+(3.010)+(18.001),

(I-746)+(3.011)+(3.025), (I-746)+(3.011)+(3.030), (I-746)+(3.011)+(3.031), (I-746)+(3.011)+(5.001), (I-746)+(3.011)+(5.002), (I-746)+(3.011)+(5.003), (I-746)+(3.011)+(5.004), (I-746)+(3.011)+(5.005), (I-746)+(3.011)+(5.006), (I-746)+(3.011)+(5.007), (I-746)+(3.011)+(5.008), (I-746)+(3.011)+(5.009), (I-746)+(3.011)+(5.010), (I-746)+(3.011)+(5.011), (I-746)+(3.011)+(5.012), (I-746)+(3.011)+(5.013), (I-746)+(3.011)+(5.014), (I-746)+(3.011)+(5.015), (I-746)+(3.011)+(5.016), (I-746)+(3.011)+(5.017), (I-746)+(3.011)+(5.018), (I-746)+(3.011)+(5.019), (I-746)+(3.011)+(5.020), (I-746)+(3.011)+(5.021), (I-746)+(3.011)+(5.022), (I-746)+(3.011)+(5.023), (I-746)+(3.011)+(6.001), (I-746)+(3.011)+(6.002), (I-746)+(3.011)+(6.003), (I-746)+(3.011)+(6.004), (I-746)+(3.011)+(7.001), (I-746)+(3.011)+(7.002), (I-746)+(3.011)+(7.003), (I-746)+(3.011)+(7.004), (I-746)+(3.011)+(7.005), (I-746)+(3.011)+(7.006), (I-746)+(3.011)+(9.001), (I-746)+(3.011)+(9.002), (I-746)+(3.011)+(9.003), (I-746)+(3.011)+(9.004), (I-746)+(3.011)+(9.005), (I-746)+(3.011)+(9.006), (I-746)+(3.011)+(9.007), (I-746)+(3.011)+(9.008), (I-746)+(3.011)+(9.009), (I-746)+(3.011)+(14.001), (I-746)+(3.011)+(14.002), (I-746)+(3.011)+(15.008), (I-746)+(3.011)+(15.011), (I-746)+(3.011)+(15.012), (I-746)+(3.011)+(15.016), (I-746)+(3.011)+(15.025), (I-746)+(3.011)+(15.027), (I-746)+(3.011)+(15.047), (I-746)+(3.011)+(15.063), (I-746)+(3.011)+(15.064), (I-746)+(3.011)+(16.001), (I-746)+(3.011)+(16.002), (I-746)+(3.011)+(16.003), (I-746)+(3.011)+(16.004), (I-746)+(3.011)+(16.005), (I-746)+(3.011)+(16.006), (I-746)+(3.011)+(16.007), (I-746)+(3.011)+(16.008), (I-746)+(3.011)+(17.001), (I-746)+(3.011)+(17.002), (I-746)+(3.011)+(17.003), (I-746)+(3.011)+(17.004), (I-746)+(3.011)+(17.005), (I-746)+(3.011)+(17.006), (I-746)+(3.011)+(17.007), (I-746)+(3.011)+(17.008), (I-746)+(3.011)+(17.009), (I-746)+(3.011)+(17.010), (I-746)+(3.011)+(17.011), (I-746)+(3.011)+(17.012), (I-746)+(3.011)+(18.001),

(I-746)+(3.012)+(3.025), (I-746)+(3.012)+(3.030), (I-746)+(3.012)+(3.031), (I-746)+(3.012)+(5.001), (I-746)+(3.012)+(5.002), (I-746)+(3.012)+(5.003), (I-746)+(3.012)+(5.004), (I-746)+(3.012)+(5.005), (I-746)+(3.012)+(5.006), (I-746)+(3.012)+(5.007), (I-746)+(3.012)+(5.008), (I-746)+(3.012)+(5.009), (I-746)+(3.012)+(5.010), (I-746)+(3.012)+(5.011), (I-746)+(3.012)+(5.012), (I-746)+(3.012)+(5.013), (I-746)+(3.012)+(5.014), (I-746)+(3.012)+(5.015), (I-746)+(3.012)+(5.016), (I-746)+(3.012)+(5.017), (I-746)+(3.012)+(5.018), (I-746)+(3.012)+(5.019), (I-746)+(3.012)+(5.020), (I-746)+(3.012)+(5.021), (I-746)+(3.012)+(5.022), (I-746)+(3.012)+(5.023), (I-746)+(3.012)+(6.001), (I-746)+(3.012)+(6.002), (I-746)+(3.012)+(6.003), (I-746)+(3.012)+(6.004), (I-746)+(3.012)+(7.001), (I-746)+(3.012)+(7.002), (I-746)+(3.012)+(7.003), (I-746)+(3.012)+(7.004), (I-746)+(3.012)+(7.005), (I-746)+(3.012)+(7.006), (I-746)+(3.012)+(9.001), (I-746)+(3.012)+(9.002), (I-746)+(3.012)+(9.003), (I-746)+(3.012)+(9.004), (I-746)+(3.012)+(9.005), (I-746)+(3.012)+(9.006), (I-746)+(3.012)+(9.007), (I-746)+(3.012)+(9.008), (I-746)+(3.012)+(9.009), (I-746)+(3.012)+(14.001), (I-746)+(3.012)+(14.002), (I-746)+(3.012)+(15.008), (I-746)+(3.012)+(15.011), (I-746)+(3.012)+(15.012), (I-746)+(3.012)+(15.016), (I-746)+(3.012)+(15.025), (I-746)+(3.012)+(15.027), (I-746)+(3.012)+(15.047), (I-746)+(3.012)+(15.063), (I-746)+(3.012)+(15.064), (I-746)+(3.012)+(16.001), (I-746)+(3.012)+(16.002), (I-746)+(3.012)+(16.003), (I-746)+(3.012)+(16.004), (I-746)+(3.012)+(16.005), (I-746)+(3.012)+(16.006), (I-746)+(3.012)+(16.007), (I-746)+(3.012)+(16.008), (I-746)+(3.012)+(17.001), (I-746)+(3.012)+(17.002), (I-746)+(3.012)+(17.003), (I-746)+(3.012)+(17.004), (I-746)+(3.012)+(17.005), (I-746)+(3.012)+(17.006), (I-746)+(3.012)+(17.007), (I-746)+(3.012)+(17.008), (I-746)+(3.012)+(17.009), (I-746)+(3.012)+(17.010), (I-746)+(3.012)+(17.011), (I-746)+(3.012)+(17.012), (I-746)+(3.012)+(18.001),

(I-746)+(3.013)+(3.025), (I-746)+(3.013)+(3.030), (I-746)+(3.013)+(3.031), (I-746)+(3.013)+(5.001), (I-746)+(3.013)+(5.002), (I-746)+(3.013)+(5.003), (I-746)+(3.013)+(5.004), (I-746)+(3.013)+(5.005), (I-746)+(3.013)+(5.006), (I-746)+(3.013)+(5.007), (I-746)+(3.013)+(5.008), (I-746)+(3.013)+(5.009), (I-746)+(3.013)+(5.010), (I-746)+(3.013)+(5.011), (I-746)+(3.013)+(5.012), (I-746)+(3.013)+(5.013), (I-746)+(3.013)+(5.014), (I-746)+(3.013)+(5.015), (I-746)+(3.013)+(5.016), (I-746)+(3.013)+(5.017), (I-746)+(3.013)+(5.018), (I-746)+(3.013)+(5.019), (I-746)+(3.013)+(5.020), (I-746)+(3.013)+(5.021), (I-746)+(3.013)+(5.022), (I-746)+(3.013)+(5.023), (I-746)+(3.013)+(6.001), (I-746)+(3.013)+(6.002), (I-746)+(3.013)+(6.003), (I-746)+(3.013)+(6.004), (I-746)+(3.013)+(7.001), (I-746)+(3.013)+(7.002), (I-746)+(3.013)+(7.003), (I-746)+(3.013)+(7.004), (I-746)+(3.013)+(7.005), (I-746)+(3.013)+(7.006), (I-746)+(3.013)+(9.001), (I-746)+(3.013)+(9.002), (I-746)+(3.013)+(9.003), (I-746)+(3.013)+(9.004), (I-746)+(3.013)+(9.005), (I-746)+(3.013)+(9.006), (I-746)+(3.013)+(9.007), (I-746)+(3.013)+(9.008), (I-746)+(3.013)+(9.009), (I-746)+(3.013)+(14.001), (I-746)+(3.013)+(14.002), (I-746)+(3.013)+(15.008), (I-746)+(3.013)+(15.011), (I-746)+(3.013)+(15.012), (I-746)+(3.013)+(15.016), (I-746)+(3.013)+(15.025), (I-746)+(3.013)+(15.027), (I-746)+(3.013)+(15.047), (I-746)+(3.013)+(15.063), (I-746)+(3.013)+(15.064), (I-746)+(3.013)+(16.001), (I-746)+(3.013)+(16.002), (I-746)+(3.013)+(16.003), (I-746)+(3.013)+(16.004), (I-746)+(3.013)+(16.005), (I-746)+(3.013)+(16.006), (I-746)+(3.013)+(16.007), (I-746)+(3.013)+(16.008), (I-746)+(3.013)+(17.001), (I-746)+(3.013)+(17.002), (I-746)+(3.013)+(17.003), (I-746)+(3.013)+(17.004), (I-746)+(3.013)+(17.005), (I-746)+(3.013)+(17.006), (I-746)+(3.013)+(17.007), (I-746)+(3.013)+(17.008), (I-746)+(3.013)+(17.009), (I-746)+(3.013)+(17.010), (I-746)+(3.013)+(17.011), (I-746)+(3.013)+(17.012), (I-746)+(3.013)+(18.001),

(I-746)+(3.014)+(3.025), (I-746)+(3.014)+(3.030), (I-746)+(3.014)+(3.031), (I-746)+(3.014)+(5.001), (I-746)+(3.014)+(5.002), (I-746)+(3.014)+(5.003), (I-746)+(3.014)+(5.004), (I-746)+(3.014)+(5.005), (I-746)+(3.014)+(5.006), (I-746)+(3.014)+(5.007), (I-746)+(3.014)+(5.008), (I-746)+(3.014)+(5.009), (I-746)+(3.014)+(5.010), (I-746)+(3.014)+(5.011), (I-746)+(3.014)+(5.012), (I-746)+(3.014)+(5.013), (I-746)+(3.014)+(5.014), (I-746)+(3.014)+(5.015), (I-746)+(3.014)+(5.016), (I-746)+(3.014)+(5.017), (I-746)+(3.014)+(5.018), (I-746)+(3.014)+(5.019), (I-746)+(3.014)+(5.020), (I-746)+(3.014)+(5.021), (I-746)+(3.014)+(5.022), (I-746)+(3.014)+(5.023), (I-746)+(3.014)+(6.001), (I-746)+(3.014)+(6.002), (I-746)+(3.014)+(6.003), (I-746)+(3.014)+(6.004), (I-746)+(3.014)+(7.001), (I-746)+(3.014)+(7.002), (I-746)+(3.014)+(7.003), (I-746)+(3.014)+(7.004), (I-746)+(3.014)+(7.005), (I-746)+(3.014)+(7.006), (I-746)+(3.014)+(9.001), (I-746)+(3.014)+(9.002), (I-746)+(3.014)+(9.003), (I-746)+(3.014)+(9.004), (I-746)+(3.014)+(9.005), (I-746)+(3.014)+(9.006), (I-746)+(3.014)+(9.007), (I-746)+(3.014)+(9.008), (I-746)+(3.014)+(9.009), (I-746)+(3.014)+(14.001), (I-746)+(3.014)+(14.002), (I-746)+(3.014)+(15.008), (I-746)+(3.014)+(15.011), (I-746)+(3.014)+(15.012), (I-746)+(3.014)+(15.016), (I-746)+(3.014)+(15.025), (I-746)+(3.014)+(15.027), (I-746)+(3.014)+(15.047), (I-746)+(3.014)+(15.063), (I-746)+(3.014)+(15.064), (I-746)+(3.014)+(16.001), (I-746)+(3.014)+(16.002), (I-746)+(3.014)+(16.003), (I-746)+(3.014)+(16.004), (I-746)+(3.014)+(16.005), (I-746)+(3.014)+(16.006), (I-746)+(3.014)+(16.007), (I-746)+(3.014)+(16.008), (I-746)+(3.014)+(17.001), (I-746)+(3.014)+(17.002), (I-746)+(3.014)+(17.003), (I-746)+(3.014)+(17.004), (I-746)+(3.014)+(17.005), (I-746)+(3.014)+(17.006), (I-746)+(3.014)+(17.007), (I-746)+(3.014)+(17.008), (I-746)+(3.014)+(17.009), (I-746)+(3.014)+(17.010), (I-746)+(3.014)+(17.011), (I-746)+(3.014)+(17.012), (I-746)+(3.014)+(18.001),

(I-746)+(3.015)+(3.025), (I-746)+(3.015)+(3.030), (I-746)+(3.015)+(3.031), (I-746)+(3.015)+(5.001), (I-746)+(3.015)+(5.002), (I-746)+(3.015)+(5.003), (I-746)+(3.015)+(5.004), (I-746)+(3.015)+(5.005), (I-746)+(3.015)+(5.006), (I-746)+(3.015)+(5.007), (I-746)+(3.015)+(5.008), (I-746)+(3.015)+(5.009), (I-746)+(3.015)+(5.010), (I-746)+(3.015)+(5.011), (I-746)+(3.015)+(5.012), (I-746)+(3.015)+(5.013), (I-746)+(3.015)+(5.014), (I-746)+(3.015)+(5.015), (I-746)+(3.015)+(5.016), (I-746)+(3.015)+(5.017), (I-746)+(3.015)+(5.018), (I-746)+(3.015)+(5.019), (I-746)+(3.015)+(5.020), (I-746)+(3.015)+(5.021), (I-746)+(3.015)+(5.022), (I-746)+(3.015)+(5.023), (I-746)+(3.015)+(6.001), (I-746)+(3.015)+(6.002), (I-746)+(3.015)+(6.003), (I-746)+(3.015)+(6.004), (I-746)+(3.015)+(7.001), (I-746)+(3.015)+(7.002), (I-746)+(3.015)+(7.003), (I-746)+(3.015)+(7.004), (I-746)+(3.015)+(7.005), (I-746)+(3.015)+(7.006), (I-746)+(3.015)+(9.001), (I-746)+(3.015)+(9.002), (I-746)+(3.015)+(9.003), (I-746)+(3.015)+(9.004), (I-746)+(3.015)+(9.005), (I-746)+(3.015)+(9.006), (I-746)+(3.015)+(9.007), (I-746)+(3.015)+(9.008), (I-746)+(3.015)+(9.009), (I-746)+(3.015)+(14.001), (I-746)+(3.015)+(14.002), (I-746)+(3.015)+(15.008), (I-746)+(3.015)+(15.011), (I-746)+(3.015)+(15.012), (I-746)+(3.015)+(15.016), (I-746)+(3.015)+(15.025), (I-746)+(3.015)+(15.027), (I-746)+(3.015)+(15.047), (I-746)+(3.015)+(15.063), (I-746)+(3.015)+(15.064), (I-746)+(3.015)+(16.001), (I-746)+(3.015)+(16.002), (I-746)+(3.015)+(16.003), (I-746)+(3.015)+(16.004), (I-746)+(3.015)+(16.005), (I-746)+(3.015)+(16.006), (I-746)+(3.015)+(16.007), (I-746)+(3.015)+(16.008), (I-746)+(3.015)+(17.001), (I-746)+(3.015)+(17.002), (I-746)+(3.015)+(17.003), (I-746)+(3.015)+(17.004), (I-746)+(3.015)+(17.005), (I-746)+(3.015)+(17.006), (I-746)+(3.015)+(17.007), (I-746)+(3.015)+(17.008), (I-746)+(3.015)+(17.009), (I-746)+(3.015)+(17.010), (I-746)+(3.015)+(17.011), (I-746)+(3.015)+(17.012), (I-746)+(3.015)+(18.001),

(I-746)+(3.016)+(3.025), (I-746)+(3.016)+(3.030), (I-746)+(3.016)+(3.031), (I-746)+(3.016)+(5.001), (I-746)+(3.016)+(5.002), (I-746)+(3.016)+(5.003), (I-746)+(3.016)+(5.004), (I-746)+(3.016)+(5.005), (I-746)+(3.016)+(5.006), (I-746)+(3.016)+(5.007), (I-746)+(3.016)+(5.008), (I-746)+(3.016)+(5.009), (I-746)+(3.016)+(5.010), (I-746)+(3.016)+(5.011), (I-746)+(3.016)+(5.012), (I-746)+(3.016)+(5.013), (I-746)+(3.016)+(5.014), (I-746)+(3.016)+(5.015), (I-746)+(3.016)+(5.016), (I-746)+(3.016)+(5.017), (I-746)+(3.016)+(5.018), (I-746)+(3.016)+(5.019), (I-746)+(3.016)+(5.020), (I-746)+(3.016)+(5.021), (I-746)+(3.016)+(5.022), (I-746)+(3.016)+(5.023), (I-746)+(3.016)+(6.001), (I-746)+(3.016)+(6.002), (I-746)+(3.016)+(6.003), (I-746)+(3.016)+(6.004), (I-746)+(3.016)+(7.001), (I-746)+(3.016)+(7.002), (I-746)+(3.016)+(7.003), (I-746)+(3.016)+(7.004), (I-746)+(3.016)+(7.005), (I-746)+(3.016)+(7.006), (I-746)+(3.016)+(9.001), (I-746)+(3.016)+(9.002), (I-746)+(3.016)+(9.003), (I-746)+(3.016)+(9.004), (I-746)+(3.016)+(9.005), (I-746)+(3.016)+(9.006), (I-746)+(3.016)+(9.007), (I-746)+(3.016)+(9.008), (I-746)+(3.016)+(9.009), (I-746)+(3.016)+(14.001), (I-746)+(3.016)+(14.002), (I-746)+(3.016)+(15.008), (I-746)+(3.016)+(15.011), (I-746)+(3.016)+(15.012), (I-746)+(3.016)+(15.016), (I-746)+(3.016)+(15.025), (I-746)+(3.016)+(15.027), (I-746)+(3.016)+(15.047), (I-746)+(3.016)+(15.063), (I-746)+(3.016)+(15.064), (I-746)+(3.016)+(16.001), (I-746)+(3.016)+(16.002), (I-746)+(3.016)+(16.003), (I-746)+(3.016)+(16.004), (I-746)+(3.016)+(16.005), (I-746)+(3.016)+(16.006), (I-746)+(3.016)+(16.007), (I-746)+(3.016)+(16.008), (I-746)+(3.016)+(17.001), (I-746)+(3.016)+(17.002), (I-746)+(3.016)+(17.003), (I-746)+(3.016)+(17.004), (I-746)+(3.016)+(17.005), (I-746)+(3.016)+(17.006), (I-746)+(3.016)+(17.007), (I-746)+(3.016)+(17.008), (I-746)+(3.016)+(17.009), (I-746)+(3.016)+(17.010), (I-746)+(3.016)+(17.011), (I-746)+(3.016)+(17.012), (I-746)+(3.016)+(18.001),

(I-746)+(3.017)+(3.025), (I-746)+(3.017)+(3.030), (I-746)+(3.017)+(3.031), (I-746)+(3.017)+(5.001), (I-746)+(3.017)+(5.002), (I-746)+(3.017)+(5.003), (I-746)+(3.017)+(5.004), (I-746)+(3.017)+(5.005), (I-746)+(3.017)+(5.006), (I-746)+(3.017)+(5.007), (I-746)+(3.017)+(5.008), (I-746)+(3.017)+(5.009), (I-746)+(3.017)+(5.010), (I-746)+(3.017)+(5.011), (I-746)+(3.017)+(5.012), (I-746)+(3.017)+(5.013), (I-746)+(3.017)+(5.014), (I-746)+(3.017)+(5.015), (I-746)+(3.017)+(5.016), (I-746)+(3.017)+(5.017), (I-746)+(3.017)+(5.018), (I-746)+(3.017)+(5.019), (I-746)+(3.017)+(5.020), (I-746)+(3.017)+(5.021), (I-746)+(3.017)+(5.022), (I-746)+(3.017)+(5.023), (I-746)+(3.017)+(6.001), (I-746)+(3.017)+(6.002), (I-746)+(3.017)+(6.003), (I-746)+(3.017)+(6.004), (I-746)+(3.017)+(7.001), (I-746)+(3.017)+(7.002), (I-746)+(3.017)+(7.003), (I-746)+(3.017)+(7.004), (I-746)+(3.017)+(7.005), (I-746)+(3.017)+(7.006), (I-746)+(3.017)+(9.001), (I-746)+(3.017)+(9.002), (I-746)+(3.017)+(9.003), (I-746)+(3.017)+(9.004), (I-746)+(3.017)+(9.005), (I-746)+(3.017)+(9.006), (I-746)+(3.017)+(9.007), (I-746)+(3.017)+(9.008), (I-746)+(3.017)+(9.009), (I-746)+(3.017)+(14.001), (I-746)+(3.017)+(14.002), (I-746)+(3.017)+(15.008), (I-746)+(3.017)+(15.011), (I-746)+(3.017)+(15.012), (I-746)+(3.017)+(15.016), (I-746)+(3.017)+(15.025), (I-746)+(3.017)+(15.027), (I-746)+(3.017)+(15.047), (I-746)+(3.017)+(15.063), (I-746)+(3.017)+(15.064), (I-746)+(3.017)+(16.001), (I-746)+(3.017)+(16.002), (I-746)+(3.017)+(16.003), (I-746)+(3.017)+(16.004), (I-746)+(3.017)+(16.005), (I-746)+(3.017)+(16.006), (I-746)+(3.017)+(16.007), (I-746)+(3.017)+(16.008), (I-746)+(3.017)+(17.001), (I-746)+(3.017)+(17.002), (I-746)+(3.017)+(17.003), (I-746)+(3.017)+(17.004), (I-746)+(3.017)+(17.005), (I-746)+(3.017)+(17.006), (I-746)+(3.017)+(17.007), (I-746)+(3.017)+(17.008), (I-746)+(3.017)+(17.009), (I-746)+(3.017)+(17.010), (I-746)+(3.017)+(17.011), (I-746)+(3.017)+(17.012), (I-746)+(3.017)+(18.001),

(I-746)+(3.018)+(3.025), (I-746)+(3.018)+(3.030), (I-746)+(3.018)+(3.031), (I-746)+(3.018)+(5.001), (I-746)+(3.018)+(5.002), (I-746)+(3.018)+(5.003), (I-746)+(3.018)+(5.004), (I-746)+(3.018)+(5.005), (I-746)+(3.018)+(5.006), (I-746)+(3.018)+(5.007), (I-746)+(3.018)+(5.008), (I-746)+(3.018)+(5.009), (I-746)+(3.018)+(5.010), (I-746)+(3.018)+(5.011), (I-746)+(3.018)+(5.012), (I-746)+(3.018)+(5.013), (I-746)+(3.018)+(5.014), (I-746)+(3.018)+(5.015), (I-746)+(3.018)+(5.016), (I-746)+(3.018)+(5.017), (I-746)+(3.018)+(5.018), (I-746)+(3.018)+(5.019), (I-746)+(3.018)+(5.020), (I-746)+(3.018)+(5.021), (I-746)+(3.018)+(5.022), (I-746)+(3.018)+(5.023), (I-746)+(3.018)+(6.001), (I-746)+(3.018)+(6.002), (I-746)+(3.018)+(6.003), (I-746)+(3.018)+(6.004), (I-746)+(3.018)+(7.001), (I-746)+(3.018)+(7.002), (I-746)+(3.018)+(7.003), (I-746)+(3.018)+(7.004), (I-746)+(3.018)+(7.005), (I-746)+(3.018)+(7.006), (I-746)+(3.018)+(9.001), (I-746)+(3.018)+(9.002), (I-746)+(3.018)+(9.003), (I-746)+(3.018)+(9.004), (I-746)+(3.018)+(9.005), (I-746)+(3.018)+(9.006), (I-746)+(3.018)+(9.007), (I-746)+(3.018)+(9.008), (I-746)+(3.018)+(9.009), (I-746)+(3.018)+(14.001), (I-746)+(3.018)+(14.002), (I-746)+(3.018)+(15.008), (I-746)+(3.018)+(15.011), (I-746)+(3.018)+(15.012), (I-746)+(3.018)+(15.016), (I-746)+(3.018)+(15.025), (I-746)+(3.018)+(15.027), (I-746)+(3.018)+(15.047), (I-746)+(3.018)+(15.063), (I-746)+(3.018)+(15.064), (I-746)+(3.018)+(16.001), (I-746)+(3.018)+(16.002), (I-746)+(3.018)+(16.003), (I-746)+(3.018)+(16.004), (I-746)+(3.018)+(16.005), (I-746)+(3.018)+(16.006), (I-746)+(3.018)+(16.007), (I-746)+(3.018)+(16.008), (I-746)+(3.018)+(17.001), (I-746)+(3.018)+(17.002), (I-746)+(3.018)+(17.003), (I-746)+(3.018)+(17.004), (I-746)+(3.018)+(17.005), (I-746)+(3.018)+(17.006), (I-746)+(3.018)+(17.007), (I-746)+(3.018)+(17.008), (I-746)+(3.018)+(17.009), (I-746)+(3.018)+(17.010), (I-746)+(3.018)+(17.011), (I-746)+(3.018)+(17.012), (I-746)+(3.018)+(18.001),

(I-746)+(3.019)+(3.025), (I-746)+(3.019)+(3.030), (I-746)+(3.019)+(3.031), (I-746)+(3.019)+(5.001), (I-746)+(3.019)+(5.002), (I-746)+(3.019)+(5.003), (I-746)+(3.019)+(5.004), (I-746)+(3.019)+(5.005), (I-746)+(3.019)+(5.006), (I-746)+(3.019)+(5.007), (I-746)+(3.019)+(5.008), (I-746)+(3.019)+(5.009), (I-746)+(3.019)+(5.010), (I-746)+(3.019)+(5.011), (I-746)+(3.019)+(5.012), (I-746)+(3.019)+(5.013), (I-746)+(3.019)+(5.014), (I-746)+(3.019)+(5.015), (I-746)+(3.019)+(5.016), (I-746)+(3.019)+(5.017), (I-746)+(3.019)+(5.018), (I-746)+(3.019)+(5.019), (I-746)+(3.019)+(5.020), (I-746)+(3.019)+(5.021), (I-746)+(3.019)+(5.022), (I-746)+(3.019)+(5.023), (I-746)+(3.019)+(6.001), (I-746)+(3.019)+(6.002), (I-746)+(3.019)+(6.003), (I-746)+(3.019)+(6.004), (I-746)+(3.019)+(7.001), (I-746)+(3.019)+(7.002), (I-746)+(3.019)+(7.003), (I-746)+(3.019)+(7.004), (I-746)+(3.019)+(7.005), (I-746)+(3.019)+(7.006), (I-746)+(3.019)+(9.001), (I-746)+(3.019)+(9.002), (I-746)+(3.019)+(9.003), (I-746)+(3.019)+(9.004), (I-746)+(3.019)+(9.005), (I-746)+(3.019)+(9.006), (I-746)+(3.019)+(9.007), (I-746)+(3.019)+(9.008), (I-746)+(3.019)+(9.009), (I-746)+(3.019)+(14.001), (I-746)+(3.019)+(14.002), (I-746)+(3.019)+(15.008), (I-746)+(3.019)+(15.011), (I-746)+(3.019)+(15.012), (I-746)+(3.019)+(15.016), (I-746)+(3.019)+(15.025), (I-746)+(3.019)+(15.027), (I-746)+(3.019)+(15.047), (I-746)+(3.019)+(15.063), (I-746)+(3.019)+(15.064), (I-746)+(3.019)+(16.001), (I-746)+(3.019)+(16.002), (I-746)+(3.019)+(16.003), (I-746)+(3.019)+(16.004), (I-746)+(3.019)+(16.005), (I-746)+(3.019)+(16.006), (I-746)+(3.019)+(16.007), (I-746)+(3.019)+(16.008), (I-746)+(3.019)+(17.001), (I-746)+(3.019)+(17.002), (I-746)+(3.019)+(17.003), (I-746)+(3.019)+(17.004), (I-746)+(3.019)+(17.005), (I-746)+(3.019)+(17.006), (I-746)+(3.019)+(17.007), (I-746)+(3.019)+(17.008), (I-746)+(3.019)+(17.009), (I-746)+(3.019)+(17.010), (I-746)+(3.019)+(17.011), (I-746)+(3.019)+(17.012), (I-746)+(3.019)+(18.001),

(I-746)+(3.020)+(3.025), (I-746)+(3.020)+(3.030), (I-746)+(3.020)+(3.031), (I-746)+(3.020)+(5.001), (I-746)+(3.020)+(5.002), (I-746)+(3.020)+(5.003), (I-746)+(3.020)+(5.004), (I-746)+(3.020)+(5.005), (I-746)+(3.020)+(5.006), (I-746)+(3.020)+(5.007), (I-746)+(3.020)+(5.008), (I-746)+(3.020)+(5.009), (I-746)+(3.020)+(5.010), (I-746)+(3.020)+(5.011), (I-746)+(3.020)+(5.012), (I-746)+(3.020)+(5.013), (I-746)+(3.020)+(5.014), (I-746)+(3.020)+(5.015), (I-746)+(3.020)+(5.016), (I-746)+(3.020)+(5.017), (I-746)+(3.020)+(5.018), (I-746)+(3.020)+(5.019), (I-746)+(3.020)+(5.020), (I-746)+(3.020)+(5.021), (I-746)+(3.020)+(5.022), (I-746)+(3.020)+(5.023), (I-746)+(3.020)+(6.001), (I-746)+(3.020)+(6.002), (I-746)+(3.020)+(6.003), (I-746)+(3.020)+(6.004), (I-746)+(3.020)+(7.001), (I-746)+(3.020)+(7.002), (I-746)+(3.020)+(7.003), (I-746)+(3.020)+(7.004), (I-746)+(3.020)+(7.005), (I-746)+(3.020)+(7.006), (I-746)+(3.020)+(9.001), (I-746)+(3.020)+(9.002), (I-746)+(3.020)+(9.003), (I-746)+(3.020)+(9.004), (I-746)+(3.020)+(9.005), (I-746)+(3.020)+(9.006), (I-746)+(3.020)+(9.007), (I-746)+(3.020)+(9.008), (I-746)+(3.020)+(9.009), (I-746)+(3.020)+(14.001), (I-746)+(3.020)+(14.002), (I-746)+(3.020)+(15.008), (I-746)+(3.020)+(15.011), (I-746)+(3.020)+(15.012), (I-746)+(3.020)+(15.016), (I-746)+(3.020)+(15.025), (I-746)+(3.020)+(15.027), (I-746)+(3.020)+(15.047), (I-746)+(3.020)+(15.063), (I-746)+(3.020)+(15.064), (I-746)+(3.020)+(16.001), (I-746)+(3.020)+(16.002), (I-746)+(3.020)+(16.003), (I-746)+(3.020)+(16.004), (I-746)+(3.020)+(16.005), (I-746)+(3.020)+(16.006), (I-746)+(3.020)+(16.007), (I-746)+(3.020)+(16.008), (I-746)+(3.020)+(17.001), (I-746)+(3.020)+(17.002), (I-746)+(3.020)+(17.003), (I-746)+(3.020)+(17.004), (I-746)+(3.020)+(17.005), (I-746)+(3.020)+(17.006), (I-746)+(3.020)+(17.007), (I-746)+(3.020)+(17.008), (I-746)+(3.020)+(17.009), (I-746)+(3.020)+(17.010), (I-746)+(3.020)+(17.011), (I-746)+(3.020)+(17.012), (I-746)+(3.020)+(18.001),

(I-746)+(3.021)+(3.025), (I-746)+(3.021)+(3.030), (I-746)+(3.021)+(3.031), (I-746)+(3.021)+(5.001), (I-746)+(3.021)+(5.002), (I-746)+(3.021)+(5.003), (I-746)+(3.021)+(5.004), (I-746)+(3.021)+(5.005), (I-746)+(3.021)+(5.006), (I-746)+(3.021)+(5.007), (I-746)+(3.021)+(5.008), (I-746)+(3.021)+(5.009), (I-746)+(3.021)+(5.010), (I-746)+(3.021)+(5.011), (I-746)+(3.021)+(5.012), (I-746)+(3.021)+(5.013), (I-746)+(3.021)+(5.014), (I-746)+(3.021)+(5.015), (I-746)+(3.021)+(5.016), (I-746)+(3.021)+(5.017), (I-746)+(3.021)+(5.018), (I-746)+(3.021)+(5.019), (I-746)+(3.021)+(5.020), (I-746)+(3.021)+(5.021), (I-746)+(3.021)+(5.022), (I-746)+(3.021)+(5.023), (I-746)+(3.021)+(6.001), (I-746)+(3.021)+(6.002), (I-746)+(3.021)+(6.003), (I-746)+(3.021)+(6.004), (I-746)+(3.021)+(7.001), (I-746)+(3.021)+(7.002), (I-746)+(3.021)+(7.003), (I-746)+(3.021)+(7.004), (I-746)+(3.021)+(7.005), (I-746)+(3.021)+(7.006), (I-746)+(3.021)+(9.001), (I-746)+(3.021)+(9.002), (I-746)+(3.021)+(9.003), (I-746)+(3.021)+(9.004), (I-746)+(3.021)+(9.005), (I-746)+(3.021)+(9.006), (I-746)+(3.021)+(9.007), (I-746)+(3.021)+(9.008), (I-746)+(3.021)+(9.009), (I-746)+(3.021)+(14.001), (I-746)+(3.021)+(14.002), (I-746)+(3.021)+(15.008), (I-746)+(3.021)+(15.011), (I-746)+(3.021)+(15.012), (I-746)+(3.021)+(15.016), (I-746)+(3.021)+(15.025), (I-746)+(3.021)+(15.027), (I-746)+(3.021)+(15.047), (I-746)+(3.021)+(15.063), (I-746)+(3.021)+(15.064), (I-746)+(3.021)+(16.001), (I-746)+(3.021)+(16.002), (I-746)+(3.021)+(16.003), (I-746)+(3.021)+(16.004), (I-746)+(3.021)+(16.005), (I-746)+(3.021)+(16.006), (I-746)+(3.021)+(16.007), (I-746)+(3.021)+(16.008), (I-746)+(3.021)+(17.001), (I-746)+(3.021)+(17.002), (I-746)+(3.021)+(17.003), (I-746)+(3.021)+(17.004), (I-746)+(3.021)+(17.005), (I-746)+(3.021)+(17.006), (I-746)+(3.021)+(17.007), (I-746)+(3.021)+(17.008), (I-746)+(3.021)+(17.009), (I-746)+(3.021)+(17.010), (I-746)+(3.021)+(17.011), (I-746)+(3.021)+(17.012), (I-746)+(3.021)+(18.001),

(I-746)+(3.022)+(3.025), (I-746)+(3.022)+(3.030), (I-746)+(3.022)+(3.031), (I-746)+(3.022)+(5.001), (I-746)+(3.022)+(5.002), (I-746)+(3.022)+(5.003), (I-746)+(3.022)+(5.004), (I-746)+(3.022)+(5.005), (I-746)+(3.022)+(5.006), (I-746)+(3.022)+(5.007), (I-746)+(3.022)+(5.008), (I-746)+(3.022)+(5.009), (I-746)+(3.022)+(5.010), (I-746)+(3.022)+(5.011), (I-746)+(3.022)+(5.012), (I-746)+(3.022)+(5.013), (I-746)+(3.022)+(5.014), (I-746)+(3.022)+(5.015), (I-746)+(3.022)+(5.016), (I-746)+(3.022)+(5.017), (I-746)+(3.022)+(5.018), (I-746)+(3.022)+(5.019), (I-746)+(3.022)+(5.020), (I-746)+(3.022)+(5.021), (I-746)+(3.022)+(5.022), (I-746)+(3.022)+(5.023), (I-746)+(3.022)+(6.001), (I-746)+(3.022)+(6.002), (I-746)+(3.022)+(6.003), (I-746)+(3.022)+(6.004), (I-746)+(3.022)+(7.001), (I-746)+(3.022)+(7.002), (I-746)+(3.022)+(7.003), (I-746)+(3.022)+(7.004), (I-746)+(3.022)+(7.005), (I-746)+(3.022)+(7.006), (I-746)+(3.022)+(9.001), (I-746)+(3.022)+(9.002), (I-746)+(3.022)+(9.003), (I-746)+(3.022)+(9.004), (I-746)+(3.022)+(9.005), (I-746)+(3.022)+(9.006), (I-746)+(3.022)+(9.007), (I-746)+(3.022)+(9.008), (I-746)+(3.022)+(9.009), (I-746)+(3.022)+(14.001), (I-746)+(3.022)+(14.002), (I-746)+(3.022)+(15.008), (I-746)+(3.022)+(15.011), (I-746)+(3.022)+(15.012), (I-746)+(3.022)+(15.016), (I-746)+(3.022)+(15.025), (I-746)+(3.022)+(15.027), (I-746)+(3.022)+(15.047), (I-746)+(3.022)+(15.063), (I-746)+(3.022)+(15.064), (I-746)+(3.022)+(16.001), (I-746)+(3.022)+(16.002), (I-746)+(3.022)+(16.003), (I-746)+(3.022)+(16.004), (I-746)+(3.022)+(16.005), (I-746)+(3.022)+(16.006), (I-746)+(3.022)+(16.007), (I-746)+(3.022)+(16.008), (I-746)+(3.022)+(17.001), (I-746)+(3.022)+(17.002), (I-746)+(3.022)+(17.003), (I-746)+(3.022)+(17.004), (I-746)+(3.022)+(17.005), (I-746)+(3.022)+(17.006), (I-746)+(3.022)+(17.007), (I-746)+(3.022)+(17.008), (I-746)+(3.022)+(17.009), (I-746)+(3.022)+(17.010), (I-746)+(3.022)+(17.011), (I-746)+(3.022)+(17.012), (I-746)+(3.022)+(18.001),

(I-746)+(3.023)+(3.025), (I-746)+(3.023)+(3.030), (I-746)+(3.023)+(3.031), (I-746)+(3.023)+(5.001), (I-746)+(3.023)+(5.002), (I-746)+(3.023)+(5.003), (I-746)+(3.023)+(5.004), (I-746)+(3.023)+(5.005), (I-746)+(3.023)+(5.006), (I-746)+(3.023)+(5.007), (I-746)+(3.023)+(5.008), (I-746)+(3.023)+(5.009), (I-746)+(3.023)+(5.010), (I-746)+(3.023)+(5.011), (I-746)+(3.023)+(5.012), (I-746)+(3.023)+(5.013), (I-746)+(3.023)+(5.014), (I-746)+(3.023)+(5.015), (I-746)+(3.023)+(5.016), (I-746)+(3.023)+(5.017), (I-746)+(3.023)+(5.018), (I-746)+(3.023)+(5.019), (I-746)+(3.023)+(5.020), (I-746)+(3.023)+(5.021), (I-746)+(3.023)+(5.022), (I-746)+(3.023)+(5.023), (I-746)+(3.023)+(6.001), (I-746)+(3.023)+(6.002), (I-746)+(3.023)+(6.003), (I-746)+(3.023)+(6.004), (I-746)+(3.023)+(7.001), (I-746)+(3.023)+(7.002), (I-746)+(3.023)+(7.003), (I-746)+(3.023)+(7.004), (I-746)+(3.023)+(7.005), (I-746)+(3.023)+(7.006), (I-746)+(3.023)+(9.001), (I-746)+(3.023)+(9.002), (I-746)+(3.023)+(9.003), (I-746)+(3.023)+(9.004), (I-746)+(3.023)+(9.005), (I-746)+(3.023)+(9.006), (I-746)+(3.023)+(9.007), (I-746)+(3.023)+(9.008), (I-746)+(3.023)+(9.009), (I-746)+(3.023)+(14.001), (I-746)+(3.023)+(14.002), (I-746)+(3.023)+(15.008), (I-746)+(3.023)+(15.011), (I-746)+(3.023)+(15.012), (I-746)+(3.023)+(15.016), (I-746)+(3.023)+(15.025), (I-746)+(3.023)+(15.027), (I-746)+(3.023)+(15.047), (I-746)+(3.023)+(15.063), (I-746)+(3.023)+(15.064), (I-746)+(3.023)+(16.001), (I-746)+(3.023)+(16.002), (I-746)+(3.023)+(16.003), (I-746)+(3.023)+(16.004), (I-746)+(3.023)+(16.005), (I-746)+(3.023)+(16.006), (I-746)+(3.023)+(16.007), (I-746)+(3.023)+(16.008), (I-746)+(3.023)+(17.001), (I-746)+(3.023)+(17.002), (I-746)+(3.023)+(17.003), (I-746)+(3.023)+(17.004), (I-746)+(3.023)+(17.005), (I-746)+(3.023)+(17.006), (I-746)+(3.023)+(17.007), (I-746)+(3.023)+(17.008), (I-746)+(3.023)+(17.009), (I-746)+(3.023)+(17.010), (I-746)+(3.023)+(17.011), (I-746)+(3.023)+(17.012), (I-746)+(3.023)+(18.001),

(I-746)+(3.024)+(3.025), (I-746)+(3.024)+(3.030), (I-746)+(3.024)+(3.031), (I-746)+(3.024)+(5.001), (I-746)+(3.024)+(5.002), (I-746)+(3.024)+(5.003), (I-746)+(3.024)+(5.004), (I-746)+(3.024)+(5.005), (I-746)+(3.024)+(5.006), (I-746)+(3.024)+(5.007), (I-746)+(3.024)+(5.008), (I-746)+(3.024)+(5.009), (I-746)+(3.024)+(5.010), (I-746)+(3.024)+(5.011), (I-746)+(3.024)+(5.012), (I-746)+(3.024)+(5.013), (I-746)+(3.024)+(5.014), (I-746)+(3.024)+(5.015), (I-746)+(3.024)+(5.016), (I-746)+(3.024)+(5.017), (I-746)+(3.024)+(5.018), (I-746)+(3.024)+(5.019), (I-746)+(3.024)+(5.020), (I-746)+(3.024)+(5.021), (I-746)+(3.024)+(5.022), (I-746)+(3.024)+(5.023), (I-746)+(3.024)+(6.001), (I-746)+(3.024)+(6.002), (I-746)+(3.024)+(6.003), (I-746)+(3.024)+(6.004), (I-746)+(3.024)+(7.001), (I-746)+(3.024)+(7.002), (I-746)+(3.024)+(7.003), (I-746)+(3.024)+(7.004), (I-746)+(3.024)+(7.005), (I-746)+(3.024)+(7.006), (I-746)+(3.024)+(9.001), (I-746)+(3.024)+(9.002), (I-746)+(3.024)+(9.003), (I-746)+(3.024)+(9.004), (I-746)+(3.024)+(9.005), (I-746)+(3.024)+(9.006), (I-746)+(3.024)+(9.007), (I-746)+(3.024)+(9.008), (I-746)+(3.024)+(9.009), (I-746)+(3.024)+(14.001), (I-746)+(3.024)+(14.002), (I-746)+(3.024)+(15.008), (I-746)+(3.024)+(15.011), (I-746)+(3.024)+(15.012), (I-746)+(3.024)+(15.016), (I-746)+(3.024)+(15.025), (I-746)+(3.024)+(15.027), (I-746)+(3.024)+(15.047), (I-746)+(3.024)+(15.063), (I-746)+(3.024)+(15.064), (I-746)+(3.024)+(16.001), (I-746)+(3.024)+(16.002), (I-746)+(3.024)+(16.003), (I-746)+(3.024)+(16.004), (I-746)+(3.024)+(16.005), (I-746)+(3.024)+(16.006), (I-746)+(3.024)+(16.007), (I-746)+(3.024)+(16.008), (I-746)+(3.024)+(17.001), (I-746)+(3.024)+(17.002), (I-746)+(3.024)+(17.003), (I-746)+(3.024)+(17.004), (I-746)+(3.024)+(17.005), (I-746)+(3.024)+(17.006), (I-746)+(3.024)+(17.007), (I-746)+(3.024)+(17.008), (I-746)+(3.024)+(17.009), (I-746)+(3.024)+(17.010), (I-746)+(3.024)+(17.011), (I-746)+(3.024)+(17.012), (I-746)+(3.024)+(18.001),

(I-746)+(3.025)+(3.030), (I-746)+(3.025)+(3.031), (I-746)+(3.025)+(5.001), (I-746)+(3.025)+(5.002), (I-746)+(3.025)+(5.003), (I-746)+(3.025)+(5.004), (I-746)+(3.025)+(5.005), (I-746)+(3.025)+(5.006), (I-746)+(3.025)+(5.007), (I-746)+(3.025)+(5.008), (I-746)+(3.025)+(5.009), (I-746)+(3.025)+(5.010), (I-746)+(3.025)+(5.011), (I-746)+(3.025)+(5.012), (I-746)+(3.025)+(5.013), (I-746)+(3.025)+(5.014), (I-746)+(3.025)+(5.015), (I-746)+(3.025)+(5.016), (I-746)+(3.025)+(5.017), (I-746)+(3.025)+(5.018), (I-746)+(3.025)+(5.019), (I-746)+(3.025)+(5.020), (I-746)+(3.025)+(5.021), (I-746)+(3.025)+(5.022), (I-746)+(3.025)+(5.023), (I-746)+(3.025)+(6.001), (I-746)+(3.025)+(6.002), (I-746)+(3.025)+(6.003), (I-746)+(3.025)+(6.004), (I-746)+(3.025)+(7.001), (I-746)+(3.025)+(7.002), (I-746)+(3.025)+(7.003), (I-746)+(3.025)+(7.004), (I-746)+(3.025)+(7.005), (I-746)+(3.025)+(7.006), (I-746)+(3.025)+(9.001), (I-746)+(3.025)+(9.002), (I-746)+(3.025)+(9.003), (I-746)+(3.025)+(9.004), (I-746)+(3.025)+(9.005), (I-746)+(3.025)+(9.006), (I-746)+(3.025)+(9.007), (I-746)+(3.025)+(9.008), (I-746)+(3.025)+(9.009), (I-746)+(3.025)+(14.001), (I-746)+(3.025)+(14.002), (I-746)+(3.025)+(15.008), (I-746)+(3.025)+(15.011), (I-746)+(3.025)+(15.012), (I-746)+(3.025)+(15.016), (I-746)+(3.025)+(15.025), (I-746)+(3.025)+(15.027), (I-746)+(3.025)+(15.047), (I-746)+(3.025)+(15.063), (I-746)+(3.025)+(15.064), (I-746)+(3.025)+(16.001), (I-746)+(3.025)+(16.002), (I-746)+(3.025)+(16.003), (I-746)+(3.025)+(16.004), (I-746)+(3.025)+(16.005), (I-746)+(3.025)+(16.006), (I-746)+(3.025)+(16.007), (I-746)+(3.025)+(16.008), (I-746)+(3.025)+(17.001), (I-746)+(3.025)+(17.002), (I-746)+(3.025)+(17.003), (I-746)+(3.025)+(17.004), (I-746)+(3.025)+(17.005), (I-746)+(3.025)+(17.006), (I-746)+(3.025)+(17.007), (I-746)+(3.025)+(17.008), (I-746)+(3.025)+(17.009), (I-746)+(3.025)+(17.010), (I-746)+(3.025)+(17.011), (I-746)+(3.025)+(17.012), (I-746)+(3.025)+(18.001),

(I-746)+(3.026)+(3.025), (I-746)+(3.026)+(3.030), (I-746)+(3.026)+(3.031), (I-746)+(3.026)+(5.001), (I-746)+(3.026)+(5.002), (I-746)+(3.026)+(5.003), (I-746)+(3.026)+(5.004), (I-746)+(3.026)+(5.005), (I-746)+(3.026)+(5.006), (I-746)+(3.026)+(5.007), (I-746)+(3.026)+(5.008), (I-746)+(3.026)+(5.009), (I-746)+(3.026)+(5.010), (I-746)+(3.026)+(5.011), (I-746)+(3.026)+(5.012), (I-746)+(3.026)+(5.013), (I-746)+(3.026)+(5.014), (I-746)+(3.026)+(5.015), (I-746)+(3.026)+(5.016), (I-746)+(3.026)+(5.017), (I-746)+(3.026)+(5.018), (I-746)+(3.026)+(5.019), (I-746)+(3.026)+(5.020), (I-746)+(3.026)+(5.021), (I-746)+(3.026)+(5.022), (I-746)+(3.026)+(5.023), (I-746)+(3.026)+(6.001), (I-746)+(3.026)+(6.002), (I-746)+(3.026)+(6.003), (I-746)+(3.026)+(6.004), (I-746)+(3.026)+(7.001), (I-746)+(3.026)+(7.002), (I-746)+(3.026)+(7.003), (I-746)+(3.026)+(7.004), (I-746)+(3.026)+(7.005), (I-746)+(3.026)+(7.006), (I-746)+(3.026)+(9.001), (I-746)+(3.026)+(9.002), (I-746)+(3.026)+(9.003), (I-746)+(3.026)+(9.004), (I-746)+(3.026)+(9.005), (I-746)+(3.026)+(9.006), (I-746)+(3.026)+(9.007), (I-746)+(3.026)+(9.008), (I-746)+(3.026)+(9.009), (I-746)+(3.026)+(14.001), (I-746)+(3.026)+(14.002), (I-746)+(3.026)+(15.008), (I-746)+(3.026)+(15.011), (I-746)+(3.026)+(15.012), (I-746)+(3.026)+(15.016), (I-746)+(3.026)+(15.025), (I-746)+(3.026)+(15.027), (I-746)+(3.026)+(15.047), (I-746)+(3.026)+(15.063), (I-746)+(3.026)+(15.064), (I-746)+(3.026)+(16.001), (I-746)+(3.026)+(16.002), (I-746)+(3.026)+(16.003), (I-746)+(3.026)+(16.004), (I-746)+(3.026)+(16.005), (I-746)+(3.026)+(16.006), (I-746)+(3.026)+(16.007), (I-746)+(3.026)+(16.008), (I-746)+(3.026)+(17.001), (I-746)+(3.026)+(17.002), (I-746)+(3.026)+(17.003), (I-746)+(3.026)+(17.004), (I-746)+(3.026)+(17.005), (I-746)+(3.026)+(17.006), (I-746)+(3.026)+(17.007), (I-746)+(3.026)+(17.008), (I-746)+(3.026)+(17.009), (I-746)+(3.026)+(17.010), (I-746)+(3.026)+(17.011), (I-746)+(3.026)+(17.012), (I-746)+(3.026)+(18.001),

(I-746)+(3.027)+(3.025), (I-746)+(3.027)+(3.030), (I-746)+(3.027)+(3.031), (I-746)+(3.027)+(5.001), (I-746)+(3.027)+(5.002), (I-746)+(3.027)+(5.003), (I-746)+(3.027)+(5.004), (I-746)+(3.027)+(5.005), (I-746)+(3.027)+(5.006), (I-746)+(3.027)+(5.007), (I-746)+(3.027)+(5.008), (I-746)+(3.027)+(5.009), (I-746)+(3.027)+(5.010), (I-746)+(3.027)+(5.011), (I-746)+(3.027)+(5.012), (I-746)+(3.027)+(5.013), (I-746)+(3.027)+(5.014), (I-746)+(3.027)+(5.015), (I-746)+(3.027)+(5.016), (I-746)+(3.027)+(5.017), (I-746)+(3.027)+(5.018), (I-746)+(3.027)+(5.019), (I-746)+(3.027)+(5.020), (I-746)+(3.027)+(5.021), (I-746)+(3.027)+(5.022), (I-746)+(3.027)+(5.023), (I-746)+(3.027)+(6.001), (I-746)+(3.027)+(6.002), (I-746)+(3.027)+(6.003), (I-746)+(3.027)+(6.004), (I-746)+(3.027)+(7.001), (I-746)+(3.027)+(7.002), (I-746)+(3.027)+(7.003), (I-746)+(3.027)+(7.004), (I-746)+(3.027)+(7.005), (I-746)+(3.027)+(7.006), (I-746)+(3.027)+(9.001), (I-746)+(3.027)+(9.002), (I-746)+(3.027)+(9.003), (I-746)+(3.027)+(9.004), (I-746)+(3.027)+(9.005), (I-746)+(3.027)+(9.006), (I-746)+(3.027)+(9.007), (I-746)+(3.027)+(9.008), (I-746)+(3.027)+(9.009), (I-746)+(3.027)+(14.001), (I-746)+(3.027)+(14.002), (I-746)+(3.027)+(15.008), (I-746)+(3.027)+(15.011), (I-746)+(3.027)+(15.012), (I-746)+(3.027)+(15.016), (I-746)+(3.027)+(15.025), (I-746)+(3.027)+(15.027), (I-746)+(3.027)+(15.047), (I-746)+(3.027)+(15.063), (I-746)+(3.027)+(15.064), (I-746)+(3.027)+(16.001), (I-746)+(3.027)+(16.002), (I-746)+(3.027)+(16.003), (I-746)+(3.027)+(16.004), (I-746)+(3.027)+(16.005), (I-746)+(3.027)+(16.006), (I-746)+(3.027)+(16.007), (I-746)+(3.027)+(16.008), (I-746)+(3.027)+(17.001), (I-746)+(3.027)+(17.002), (I-746)+(3.027)+(17.003), (I-746)+(3.027)+(17.004), (I-746)+(3.027)+(17.005), (I-746)+(3.027)+(17.006), (I-746)+(3.027)+(17.007), (I-746)+(3.027)+(17.008), (I-746)+(3.027)+(17.009), (I-746)+(3.027)+(17.010), (I-746)+(3.027)+(17.011), (I-746)+(3.027)+(17.012), (I-746)+(3.027)+(18.001),

(I-746)+(3.028)+(3.025), (I-746)+(3.028)+(3.030), (I-746)+(3.028)+(3.031), (I-746)+(3.028)+(5.001), (I-746)+(3.028)+(5.002), (I-746)+(3.028)+(5.003), (I-746)+(3.028)+(5.004), (I-746)+(3.028)+(5.005), (I-746)+(3.028)+(5.006), (I-746)+(3.028)+(5.007), (I-746)+(3.028)+(5.008), (I-746)+(3.028)+(5.009), (I-746)+(3.028)+(5.010), (I-746)+(3.028)+(5.011), (I-746)+(3.028)+(5.012), (I-746)+(3.028)+(5.013), (I-746)+(3.028)+(5.014), (I-746)+(3.028)+(5.015), (I-746)+(3.028)+(5.016), (I-746)+(3.028)+(5.017), (I-746)+(3.028)+(5.018), (I-746)+(3.028)+(5.019), (I-746)+(3.028)+(5.020), (I-746)+(3.028)+(5.021), (I-746)+(3.028)+(5.022), (I-746)+(3.028)+(5.023), (I-746)+(3.028)+(6.001), (I-746)+(3.028)+(6.002), (I-746)+(3.028)+(6.003), (I-746)+(3.028)+(6.004), (I-746)+(3.028)+(7.001), (I-746)+(3.028)+(7.002), (I-746)+(3.028)+(7.003), (I-746)+(3.028)+(7.004), (I-746)+(3.028)+(7.005), (I-746)+(3.028)+(7.006), (I-746)+(3.028)+(9.001), (I-746)+(3.028)+(9.002), (I-746)+(3.028)+(9.003), (I-746)+(3.028)+(9.004), (I-746)+(3.028)+(9.005), (I-746)+(3.028)+(9.006), (I-746)+(3.028)+(9.007), (I-746)+(3.028)+(9.008), (I-746)+(3.028)+(9.009), (I-746)+(3.028)+(14.001), (I-746)+(3.028)+(14.002), (I-746)+(3.028)+(15.008), (I-746)+(3.028)+(15.011), (I-746)+(3.028)+(15.012), (I-746)+(3.028)+(15.016), (I-746)+(3.028)+(15.025), (I-746)+(3.028)+(15.027), (I-746)+(3.028)+(15.047), (I-746)+(3.028)+(15.063), (I-746)+(3.028)+(15.064), (I-746)+(3.028)+(16.001), (I-746)+(3.028)+(16.002), (I-746)+(3.028)+(16.003), (I-746)+(3.028)+(16.004), (I-746)+(3.028)+(16.005), (I-746)+(3.028)+(16.006), (I-746)+(3.028)+(16.007), (I-746)+(3.028)+(16.008), (I-746)+(3.028)+(17.001), (I-746)+(3.028)+(17.002), (I-746)+(3.028)+(17.003), (I-746)+(3.028)+(17.004), (I-746)+(3.028)+(17.005), (I-746)+(3.028)+(17.006), (I-746)+(3.028)+(17.007), (I-746)+(3.028)+(17.008), (I-746)+(3.028)+(17.009), (I-746)+(3.028)+(17.010), (I-746)+(3.028)+(17.011), (I-746)+(3.028)+(17.012), (I-746)+(3.028)+(18.001),

(I-746)+(3.029)+(3.025), (I-746)+(3.029)+(3.030), (I-746)+(3.029)+(3.031), (I-746)+(3.029)+(5.001), (I-746)+(3.029)+(5.002), (I-746)+(3.029)+(5.003), (I-746)+(3.029)+(5.004), (I-746)+(3.029)+(5.005), (I-746)+(3.029)+(5.006), (I-746)+(3.029)+(5.007), (I-746)+(3.029)+(5.008), (I-746)+(3.029)+(5.009), (I-746)+(3.029)+(5.010), (I-746)+(3.029)+(5.011), (I-746)+(3.029)+(5.012), (I-746)+(3.029)+(5.013), (I-746)+(3.029)+(5.014), (I-746)+(3.029)+(5.015), (I-746)+(3.029)+(5.016), (I-746)+(3.029)+(5.017), (I-746)+(3.029)+(5.018), (I-746)+(3.029)+(5.019), (I-746)+(3.029)+(5.020), (I-746)+(3.029)+(5.021), (I-746)+(3.029)+(5.022), (I-746)+(3.029)+(5.023), (I-746)+(3.029)+(6.001), (I-746)+(3.029)+(6.002), (I-746)+(3.029)+(6.003), (I-746)+(3.029)+(6.004), (I-746)+(3.029)+(7.001), (I-746)+(3.029)+(7.002), (I-746)+(3.029)+(7.003), (I-746)+(3.029)+(7.004), (I-746)+(3.029)+(7.005), (I-746)+(3.029)+(7.006), (I-746)+(3.029)+(9.001), (I-746)+(3.029)+(9.002), (I-746)+(3.029)+(9.003), (I-746)+(3.029)+(9.004), (I-746)+(3.029)+(9.005), (I-746)+(3.029)+(9.006), (I-746)+(3.029)+(9.007), (I-746)+(3.029)+(9.008), (I-746)+(3.029)+(9.009), (I-746)+(3.029)+(14.001), (I-746)+(3.029)+(14.002), (I-746)+(3.029)+(15.008), (I-746)+(3.029)+(15.011), (I-746)+(3.029)+(15.012), (I-746)+(3.029)+(15.016), (I-746)+(3.029)+(15.025), (I-746)+(3.029)+(15.027), (I-746)+(3.029)+(15.047), (I-746)+(3.029)+(15.063), (I-746)+(3.029)+(15.064), (I-746)+(3.029)+(16.001), (I-746)+(3.029)+(16.002), (I-746)+(3.029)+(16.003), (I-746)+(3.029)+(16.004), (I-746)+(3.029)+(16.005), (I-746)+(3.029)+(16.006), (I-746)+(3.029)+(16.007), (I-746)+(3.029)+(16.008), (I-746)+(3.029)+(17.001), (I-746)+(3.029)+(17.002), (I-746)+(3.029)+(17.003), (I-746)+(3.029)+(17.004), (I-746)+(3.029)+(17.005), (I-746)+(3.029)+(17.006), (I-746)+(3.029)+(17.007), (I-746)+(3.029)+(17.008), (I-746)+(3.029)+(17.009), (I-746)+(3.029)+(17.010), (I-746)+(3.029)+(17.011), (I-746)+(3.029)+(17.012), (I-746)+(3.029)+(18.001),

(I-746)+(3.030)+(3.025), (I-746)+(3.030)+(3.031), (I-746)+(3.030)+(5.001), (I-746)+(3.030)+(5.002), (I-746)+(3.030)+(5.003), (I-746)+(3.030)+(5.004), (I-746)+(3.030)+(5.005), (I-746)+(3.030)+(5.006), (I-746)+(3.030)+(5.007), (I-746)+(3.030)+(5.008), (I-746)+(3.030)+(5.009), (I-746)+(3.030)+(5.010), (I-746)+(3.030)+(5.011), (I-746)+(3.030)+(5.012), (I-746)+(3.030)+(5.013), (I-746)+(3.030)+(5.014), (I-746)+(3.030)+(5.015), (I-746)+(3.030)+(5.016), (I-746)+(3.030)+(5.017), (I-746)+(3.030)+(5.018), (I-746)+(3.030)+(5.019), (I-746)+(3.030)+(5.020), (I-746)+(3.030)+(5.021), (I-746)+(3.030)+(5.022), (I-746)+(3.030)+(5.023), (I-746)+(3.030)+(6.001), (I-746)+(3.030)+(6.002), (I-746)+(3.030)+(6.003), (I-746)+(3.030)+(6.004), (I-746)+(3.030)+(7.001), (I-746)+(3.030)+(7.002), (I-746)+(3.030)+(7.003), (I-746)+(3.030)+(7.004), (I-746)+(3.030)+(7.005), (I-746)+(3.030)+(7.006), (I-746)+(3.030)+(9.001), (I-746)+(3.030)+(9.002), (I-746)+(3.030)+(9.003), (I-746)+(3.030)+(9.004), (I-746)+(3.030)+(9.005), (I-746)+(3.030)+(9.006), (I-746)+(3.030)+(9.007), (I-746)+(3.030)+(9.008), (I-746)+(3.030)+(9.009), (I-746)+(3.030)+(14.001), (I-746)+(3.030)+(14.002), (I-746)+(3.030)+(15.008), (I-746)+(3.030)+(15.011), (I-746)+(3.030)+(15.012), (I-746)+(3.030)+(15.016), (I-746)+(3.030)+(15.025), (I-746)+(3.030)+(15.027), (I-746)+(3.030)+(15.047), (I-746)+(3.030)+(15.063), (I-746)+(3.030)+(15.064), (I-746)+(3.030)+(16.001), (I-746)+(3.030)+(16.002), (I-746)+(3.030)+(16.003), (I-746)+(3.030)+(16.004), (I-746)+(3.030)+(16.005), (I-746)+(3.030)+(16.006), (I-746)+(3.030)+(16.007), (I-746)+(3.030)+(16.008), (I-746)+(3.030)+(17.001), (I-746)+(3.030)+(17.002), (I-746)+(3.030)+(17.003), (I-746)+(3.030)+(17.004), (I-746)+(3.030)+(17.005), (I-746)+(3.030)+(17.006), (I-746)+(3.030)+(17.007), (I-746)+(3.030)+(17.008), (I-746)+(3.030)+(17.009), (I-746)+(3.030)+(17.010), (I-746)+(3.030)+(17.011), (I-746)+(3.030)+(17.012), (I-746)+(3.030)+(18.001),

(I-746)+(3.031)+(3.025), (I-746)+(3.031)+(3.030), (I-746)+(3.031)+(5.001), (I-746)+(3.031)+(5.002), (I-746)+(3.031)+(5.003), (I-746)+(3.031)+(5.004), (I-746)+(3.031)+(5.005), (I-746)+(3.031)+(5.006), (I-746)+(3.031)+(5.007), (I-746)+(3.031)+(5.008), (I-746)+(3.031)+(5.009), (I-746)+(3.031)+(5.010), (I-746)+(3.031)+(5.011), (I-746)+(3.031)+(5.012), (I-746)+(3.031)+(5.013), (I-746)+(3.031)+(5.014), (I-746)+(3.031)+(5.015), (I-746)+(3.031)+(5.016), (I-746)+(3.031)+(5.017), (I-746)+(3.031)+(5.018), (I-746)+(3.031)+(5.019), (I-746)+(3.031)+(5.020), (I-746)+(3.031)+(5.021), (I-746)+(3.031)+(5.022), (I-746)+(3.031)+(5.023), (I-746)+(3.031)+(6.001), (I-746)+(3.031)+(6.002), (I-746)+(3.031)+(6.003), (I-746)+(3.031)+(6.004), (I-746)+(3.031)+(7.001), (I-746)+(3.031)+(7.002), (I-746)+(3.031)+(7.003), (I-746)+(3.031)+(7.004), (I-746)+(3.031)+(7.005), (I-746)+(3.031)+(7.006), (I-746)+(3.031)+(9.001), (I-746)+(3.031)+(9.002), (I-746)+(3.031)+(9.003), (I-746)+(3.031)+(9.004), (I-746)+(3.031)+(9.005), (I-746)+(3.031)+(9.006), (I-746)+(3.031)+(9.007), (I-746)+(3.031)+(9.008), (I-746)+(3.031)+(9.009), (I-746)+(3.031)+(14.001), (I-746)+(3.031)+(14.002), (I-746)+(3.031)+(15.008), (I-746)+(3.031)+(15.011), (I-746)+(3.031)+(15.012), (I-746)+(3.031)+(15.016), (I-746)+(3.031)+(15.025), (I-746)+(3.031)+(15.027), (I-746)+(3.031)+(15.047), (I-746)+(3.031)+(15.063), (I-746)+(3.031)+(15.064), (I-746)+(3.031)+(16.001), (I-746)+(3.031)+(16.002), (I-746)+(3.031)+(16.003), (I-746)+(3.031)+(16.004), (I-746)+(3.031)+(16.005), (I-746)+(3.031)+(16.006), (I-746)+(3.031)+(16.007), (I-746)+(3.031)+(16.008), (I-746)+(3.031)+(17.001), (I-746)+(3.031)+(17.002), (I-746)+(3.031)+(17.003), (I-746)+(3.031)+(17.004), (I-746)+(3.031)+(17.005), (I-746)+(3.031)+(17.006), (I-746)+(3.031)+(17.007), (I-746)+(3.031)+(17.008), (I-746)+(3.031)+(17.009), (I-746)+(3.031)+(17.010), (I-746)+(3.031)+(17.011), (I-746)+(3.031)+(17.012), (I-746)+(3.031)+(18.001),

(I-746)+(5.001)+(9.001), (I-746)+(5.001)+(9.002), (I-746)+(5.001)+(9.003), (I-746)+(5.001)+(9.004), (I-746)+(5.001)+(9.005), (I-746)+(5.001)+(9.006), (I-746)+(5.001)+(9.007), (I-746)+(5.001)+(9.008), (I-746)+(5.001)+(9.009), (I-746)+(5.001)+(15.012), (I-746)+(5.001)+(15.016), (I-746)+(5.001)+(15.025), (I-746)+(5.001)+(15.027), (I-746)+(5.001)+(15.047), (I-746)+(5.001)+(15.063), (I-746)+(5.001)+(15.064),

(I-746)+(5.002)+(9.001), (I-746)+(5.002)+(9.002), (I-746)+(5.002)+(9.003), (I-746)+(5.002)+(9.004), (I-746)+(5.002)+(9.005), (I-746)+(5.002)+(9.006), (I-746)+(5.002)+(9.007), (I-746)+(5.002)+(9.008), (I-746)+(5.002)+(9.009), (I-746)+(5.002)+(15.012), (I-746)+(5.002)+(15.016), (I-746)+(5.002)+(15.025), (I-746)+(5.002)+(15.027), (I-746)+(5.002)+(15.047), (I-746)+(5.002)+(15.063), (I-746)+(5.002)+(15.064),

(I-746)+(5.003)+(9.001), (I-746)+(5.003)+(9.002), (I-746)+(5.003)+(9.003), (I-746)+(5.003)+(9.004), (I-746)+(5.003)+(9.005), (I-746)+(5.003)+(9.006), (I-746)+(5.003)+(9.007), (I-746)+(5.003)+(9.008), (I-746)+(5.003)+(9.009), (I-746)+(5.003)+(15.012), (I-746)+(5.003)+(15.016), (I-746)+(5.003)+(15.025), (I-746)+(5.003)+(15.027), (I-746)+(5.003)+(15.047), (I-746)+(5.003)+(15.063), (I-746)+(5.003)+(15.064),

(I-746)+(5.004)+(9.001), (I-746)+(5.004)+(9.002), (I-746)+(5.004)+(9.003), (I-746)+(5.004)+(9.004), (I-746)+(5.004)+(9.005), (I-746)+(5.004)+(9.006), (I-746)+(5.004)+(9.007), (I-746)+(5.004)+(9.008), (I-746)+(5.004)+(9.009), (I-746)+(5.004)+(15.012), (I-746)+(5.004)+(15.016), (I-746)+(5.004)+(15.025), (I-746)+(5.004)+(15.027), (I-746)+(5.004)+(15.047), (I-746)+(5.004)+(15.063), (I-746)+(5.004)+(15.064),

(I-746)+(5.005)+(9.001), (I-746)+(5.005)+(9.002), (I-746)+(5.005)+(9.003), (I-746)+(5.005)+(9.004), (I-746)+(5.005)+(9.005), (I-746)+(5.005)+(9.006), (I-746)+(5.005)+(9.007), (I-746)+(5.005)+(9.008), (I-746)+(5.005)+(9.009), (I-746)+(5.005)+(15.012), (I-746)+(5.005)+(15.016), (I-746)+(5.005)+(15.025), (I-746)+(5.005)+(15.027), (I-746)+(5.005)+(15.047), (I-746)+(5.005)+(15.063), (I-746)+(5.005)+(15.064),

(I-746)+(5.006)+(9.001), (I-746)+(5.006)+(9.002), (I-746)+(5.006)+(9.003), (I-746)+(5.006)+(9.004), (I-746)+(5.006)+(9.005), (I-746)+(5.006)+(9.006), (I-746)+(5.006)+(9.007), (I-746)+(5.006)+(9.008), (I-746)+(5.006)+(9.009), (I-746)+(5.006)+(15.012), (I-746)+(5.006)+(15.016), (I-746)+(5.006)+(15.025), (I-746)+(5.006)+(15.027), (I-746)+(5.006)+(15.047), (I-746)+(5.006)+(15.063), (I-746)+(5.006)+(15.064),

(I-746)+(5.007)+(9.001), (I-746)+(5.007)+(9.002), (I-746)+(5.007)+(9.003), (I-746)+(5.007)+(9.004), (I-746)+(5.007)+(9.005), (I-746)+(5.007)+(9.006), (I-746)+(5.007)+(9.007), (I-746)+(5.007)+(9.008), (I-746)+(5.007)+(9.009), (I-746)+(5.007)+(15.012), (I-746)+(5.007)+(15.016), (I-746)+(5.007)+(15.025), (I-746)+(5.007)+(15.027), (I-746)+(5.007)+(15.047), (I-746)+(5.007)+(15.063), (I-746)+(5.007)+(15.064),

(I-746)+(5.008)+(9.001), (I-746)+(5.008)+(9.002), (I-746)+(5.008)+(9.003), (I-746)+(5.008)+(9.004), (I-746)+(5.008)+(9.005), (I-746)+(5.008)+(9.006), (I-746)+(5.008)+(9.007), (I-746)+(5.008)+(9.008), (I-746)+(5.008)+(9.009), (I-746)+(5.008)+(15.012), (I-746)+(5.008)+(15.016), (I-746)+(5.008)+(15.025), (I-746)+(5.008)+(15.027), (I-746)+(5.008)+(15.047), (I-746)+(5.008)+(15.063), (I-746)+(5.008)+(15.064),

(I-746)+(5.009)+(9.001), (I-746)+(5.009)+(9.002), (I-746)+(5.009)+(9.003), (I-746)+(5.009)+(9.004), (I-746)+(5.009)+(9.005), (I-746)+(5.009)+(9.006), (I-746)+(5.009)+(9.007), (I-746)+(5.009)+(9.008), (I-746)+(5.009)+(9.009), (I-746)+(5.009)+(15.012), (I-746)+(5.009)+(15.016), (I-746)+(5.009)+(15.025), (I-746)+(5.009)+(15.027), (I-746)+(5.009)+(15.047), (I-746)+(5.009)+(15.063), (I-746)+(5.009)+(15.064),

(I-746)+(5.010)+(9.001), (I-746)+(5.010)+(9.002), (I-746)+(5.010)+(9.003), (I-746)+(5.010)+(9.004), (I-746)+(5.010)+(9.005), (I-746)+(5.010)+(9.006), (I-746)+(5.010)+(9.007), (I-746)+(5.010)+(9.008), (I-746)+(5.010)+(9.009), (I-746)+(5.010)+(15.012), (I-746)+(5.010)+(15.016), (I-746)+(5.010)+(15.025), (I-746)+(5.010)+(15.027), (I-746)+(5.010)+(15.047), (I-746)+(5.010)+(15.063), (I-746)+(5.010)+(15.064),

(I-746)+(5.011)+(9.001), (I-746)+(5.011)+(9.002), (I-746)+(5.011)+(9.003), (I-746)+(5.011)+(9.004), (I-746)+(5.011)+(9.005), (I-746)+(5.011)+(9.006), (I-746)+(5.011)+(9.007), (I-746)+(5.011)+(9.008), (I-746)+(5.011)+(9.009), (I-746)+(5.011)+(15.012), (I-746)+(5.011)+(15.016), (I-746)+(5.011)+(15.025), (I-746)+(5.011)+(15.027), (I-746)+(5.011)+(15.047), (I-746)+(5.011)+(15.063), (I-746)+(5.011)+(15.064),

(I-746)+(5.012)+(9.001), (I-746)+(5.012)+(9.002), (I-746)+(5.012)+(9.003), (I-746)+(5.012)+(9.004), (I-746)+(5.012)+(9.005), (I-746)+(5.012)+(9.006), (I-746)+(5.012)+(9.007), (I-746)+(5.012)+(9.008), (I-746)+(5.012)+(9.009), (I-746)+(5.012)+(15.012), (I-746)+(5.012)+(15.016), (I-746)+(5.012)+(15.025), (I-746)+(5.012)+(15.027), (I-746)+(5.012)+(15.047), (I-746)+(5.012)+(15.063), (I-746)+(5.012)+(15.064),

(I-746)+(5.013)+(9.001), (I-746)+(5.013)+(9.002), (I-746)+(5.013)+(9.003), (I-746)+(5.013)+(9.004), (I-746)+(5.013)+(9.005), (I-746)+(5.013)+(9.006), (I-746)+(5.013)+(9.007), (I-746)+(5.013)+(9.008), (I-746)+(5.013)+(9.009), (I-746)+(5.013)+(15.012), (I-746)+(5.013)+(15.016), (I-746)+(5.013)+(15.025), (I-746)+(5.013)+(15.027), (I-746)+(5.013)+(15.047), (I-746)+(5.013)+(15.063), (I-746)+(5.013)+(15.064),

(I-746)+(5.014)+(9.001), (I-746)+(5.014)+(9.002), (I-746)+(5.014)+(9.003), (I-746)+(5.014)+(9.004), (I-746)+(5.014)+(9.005), (I-746)+(5.014)+(9.006), (I-746)+(5.014)+(9.007), (I-746)+(5.014)+(9.008), (I-746)+(5.014)+(9.009), (I-746)+(5.014)+(15.012), (I-746)+(5.014)+(15.016), (I-746)+(5.014)+(15.025), (I-746)+(5.014)+(15.027), (I-746)+(5.014)+(15.047), (I-746)+(5.014)+(15.063), (I-746)+(5.014)+(15.064),

(I-746)+(5.015)+(9.001), (I-746)+(5.015)+(9.002), (I-746)+(5.015)+(9.003), (I-746)+(5.015)+(9.004), (I-746)+(5.015)+(9.005), (I-746)+(5.015)+(9.006), (I-746)+(5.015)+(9.007), (I-746)+(5.015)+(9.008), (I-746)+(5.015)+(9.009), (I-746)+(5.015)+(15.012), (I-746)+(5.015)+(15.016), (I-746)+(5.015)+(15.025), (I-746)+(5.015)+(15.027), (I-746)+(5.015)+(15.047), (I-746)+(5.015)+(15.063), (I-746)+(5.015)+(15.064),

(I-746)+(5.016)+(9.001), (I-746)+(5.016)+(9.002), (I-746)+(5.016)+(9.003), (I-746)+(5.016)+(9.004), (I-746)+(5.016)+(9.005), (I-746)+(5.016)+(9.006), (I-746)+(5.016)+(9.007), (I-746)+(5.016)+(9.008), (I-746)+(5.016)+(9.009), (I-746)+(5.016)+(15.012), (I-746)+(5.016)+(15.016), (I-746)+(5.016)+(15.025), (I-746)+(5.016)+(15.027), (I-746)+(5.016)+(15.047), (I-746)+(5.016)+(15.063), (I-746)+(5.016)+(15.064),

(I-746)+(5.017)+(9.001), (I-746)+(5.017)+(9.002), (I-746)+(5.017)+(9.003), (I-746)+(5.017)+(9.004), (I-746)+(5.017)+(9.005), (I-746)+(5.017)+(9.006), (I-746)+(5.017)+(9.007), (I-746)+(5.017)+(9.008), (I-746)+(5.017)+(9.009), (I-746)+(5.017)+(15.012), (I-746)+(5.017)+(15.016), (I-746)+(5.017)+(15.025), (I-746)+(5.017)+(15.027), (I-746)+(5.017)+(15.047), (I-746)+(5.017)+(15.063), (I-746)+(5.017)+(15.064),

(I-746)+(5.018)+(9.001), (I-746)+(5.018)+(9.002), (I-746)+(5.018)+(9.003), (I-746)+(5.018)+(9.004), (I-746)+(5.018)+(9.005), (I-746)+(5.018)+(9.006), (I-746)+(5.018)+(9.007), (I-746)+(5.018)+(9.008), (I-746)+(5.018)+(9.009), (I-746)+(5.018)+(15.012), (I-746)+(5.018)+(15.016), (I-746)+(5.018)+(15.025), (I-746)+(5.018)+(15.027), (I-746)+(5.018)+(15.047), (I-746)+(5.018)+(15.063), (I-746)+(5.018)+(15.064),

(I-746)+(5.019)+(9.001), (I-746)+(5.019)+(9.002), (I-746)+(5.019)+(9.003), (I-746)+(5.019)+(9.004), (I-746)+(5.019)+(9.005), (I-746)+(5.019)+(9.006), (I-746)+(5.019)+(9.007), (I-746)+(5.019)+(9.008), (I-746)+(5.019)+(9.009), (I-746)+(5.019)+(15.012), (I-746)+(5.019)+(15.016), (I-746)+(5.019)+(15.025), (I-746)+(5.019)+(15.027), (I-746)+(5.019)+(15.047), (I-746)+(5.019)+(15.063), (I-746)+(5.019)+(15.064),

(I-746)+(5.020)+(9.001), (I-746)+(5.020)+(9.002), (I-746)+(5.020)+(9.003), (I-746)+(5.020)+(9.004), (I-746)+(5.020)+(9.005), (I-746)+(5.020)+(9.006), (I-746)+(5.020)+(9.007), (I-746)+(5.020)+(9.008), (I-746)+(5.020)+(9.009), (I-746)+(5.020)+(15.012), (I-746)+(5.020)+(15.016), (I-746)+(5.020)+(15.025), (I-746)+(5.020)+(15.027), (I-746)+(5.020)+(15.047), (I-746)+(5.020)+(15.063), (I-746)+(5.020)+(15.064),

(I-746)+(5.021)+(9.001), (I-746)+(5.021)+(9.002), (I-746)+(5.021)+(9.003), (I-746)+(5.021)+(9.004), (I-746)+(5.021)+(9.005), (I-746)+(5.021)+(9.006), (I-746)+(5.021)+(9.007), (I-746)+(5.021)+(9.008), (I-746)+(5.021)+(9.009), (I-746)+(5.021)+(15.012), (I-746)+(5.021)+(15.016), (I-746)+(5.021)+(15.025), (I-746)+(5.021)+(15.027), (I-746)+(5.021)+(15.047), (I-746)+(5.021)+(15.063), (I-746)+(5.021)+(15.064),

(I-746)+(5.022)+(9.001), (I-746)+(5.022)+(9.002), (I-746)+(5.022)+(9.003), (I-746)+(5.022)+(9.004), (I-746)+(5.022)+(9.005), (I-746)+(5.022)+(9.006), (I-746)+(5.022)+(9.007), (I-746)+(5.022)+(9.008), (I-746)+(5.022)+(9.009), (I-746)+(5.022)+(15.012), (I-746)+(5.022)+(15.016), (I-746)+(5.022)+(15.025), (I-746)+(5.022)+(15.027), (I-746)+(5.022)+(15.047), (I-746)+(5.022)+(15.063), (I-746)+(5.022)+(15.064),

(I-746)+(5.023)+(9.001), (I-746)+(5.023)+(9.002), (I-746)+(5.023)+(9.003), (I-746)+(5.023)+(9.004), (I-746)+(5.023)+(9.005), (I-746)+(5.023)+(9.006), (I-746)+(5.023)+(9.007), (I-746)+(5.023)+(9.008), (I-746)+(5.023)+(9.009), (I-746)+(5.023)+(15.012), (I-746)+(5.023)+(15.016), (I-746)+(5.023)+(15.025), (I-746)+(5.023)+(15.027), (I-746)+(5.023)+(15.047), (I-746)+(5.023)+(15.063), (I-746)+(5.023)+(15.064).

If two compounds (B) are present in the combinations according to the invention, preferred compound combinations are also selected from the group (G4-C) consisting of the following mixtures:

(I-749)+(1.001)+(1.002), (I-749)+(1.001)+(1.003), (I-749)+(1.001)+(1.004), (I-749)+(1.001)+(1.005), (I-749)+(1.001)+(1.006), (I-749)+(1.001)+(1.007), (I-749)+(1.001)+(1.008), (I-749)+(1.001)+(1.009), (I-749)+(1.001)+(1.010), (I-749)+(1.001)+(1.011), (I-749)+(1.001)+(1.012), (I-749)+(1.001)+(1.013), (I-749)+(1.001)+(1.014), (I-749)+(1.001)+(1.015), (I-749)+(1.001)+(1.016), (I-749)+(1.001)+(1.017), (I-749)+(1.001)+(1.018), (I-749)+(1.001)+(1.019), (I-749)+(1.001)+(1.020), (I-749)+(1.001)+(1.021), (I-749)+(1.001)+(1.022), (I-749)+(1.001)+(1.023), (I-749)+(1.001)+(1.024), (I-749)+(1.001)+(1.025), (I-749)+(1.001)+(1.026), (I-749)+(1.001)+(1.027), (I-749)+(1.001)+(1.028), (I-749)+(1.001)+(1.029), (I-749)+(1.001)+(1.030), (I-749)+(1.001)+(1.031), (I-749)+(1.001)+(1.032), (I-749)+(1.001)+(1.033), (I-749)+(1.001)+(1.034), (I-749)+(1.001)+(1.035), (I-749)+(1.001)+(1.036), (I-749)+(1.001)+(1.037), (I-749)+(1.001)+(1.038), (I-749)+(1.001)+(1.039), (I-749)+(1.001)+(1.040), (I-749)+(1.001)+(1.041), (I-749)+(1.001)+(1.042), (I-749)+(1.001)+(1.043), (I-749)+(1.001)+(1.044), (I-749)+(1.001)+(1.045), (I-749)+(1.001)+(1.046), (I-749)+(1.001)+(1.047), (I-749)+(1.001)+(1.048), (I-749)+(1.001)+(1.049), (I-749)+(1.001)+(1.050), (I-749)+(1.001)+(1.051), (I-749)+(1.001)+(1.052), (I-749)+(1.001)+(1.053), (I-749)+(1.001)+(1.054), (I-749)+(1.001)+(1.055), (I-749)+(1.001)+(1.056), (I-749)+(1.001)+(1.057), (I-749)+(1.001)+(1.058), (I-749)+(1.001)+(1.059), (I-749)+(1.001)+(1.060), (I-749)+(1.001)+(1.061), (I-749)+(1.001)+(1.062), (I-749)+(1.001)+(1.063), (I-749)+(1.001)+(1.064), (I-749)+(1.001)+(1.065), (I-749)+(1.001)+(1.066), (I-749)+(1.001)+(1.067), (I-749)+(1.001)+(1.068), (I-749)+(1.001)+(1.069), (I-749)+(1.001)+(1.070), (I-749)+(1.001)+(1.071), (I-749)+(1.001)+(1.072), (I-749)+(1.001)+(1.073), (I-749)+(1.001)+(1.074), (I-749)+(1.001)+(1.075), (I-749)+(1.001)+(1.076), (I-749)+(1.001)+(1.077), (I-749)+(1.001)+(1.078), (I-749)+(1.001)+(1.079), (I-749)+(1.001)+(1.080), (I-749)+(1.001)+(1.081), (I-749)+(1.001)+(1.082), (I-749)+(1.001)+(1.083), (I-749)+(1.001)+(1.084), (I-749)+(1.001)+(1.085), (I-749)+(1.001)+(1.086), (I-749)+(1.001)+(1.087), (I-749)+(1.001)+(1.088), (I-749)+(1.001)+(1.089), (I-749)+(1.001)+(1.090), (I-749)+(1.001)+(1.091), (I-749)+(1.001)+(1.092), (I-749)+(1.001)+(2.001), (I-749)+(1.001)+(2.002), (I-749)+(1.001)+(2.003), (I-749)+(1.001)+(2.004), (I-749)+(1.001)+(2.005), (I-749)+(1.001)+(2.006), (I-749)+(1.001)+(2.007), (I-749)+(1.001)+(2.008), (I-749)+(1.001)+(2.009), (I-749)+(1.001)+(2.010), (I-749)+(1.001)+(2.011), (I-749)+(1.001)+(2.012), (I-749)+(1.001)+(2.013), (I-749)+(1.001)+(2.014), (I-749)+(1.001)+(2.015), (I-749)+(1.001)+(2.016), (I-749)+(1.001)+(2.017), (I-749)+(1.001)+(2.018), (I-749)+(1.001)+(2.019), (I-749)+(1.001)+(2.020), (I-749)+(1.001)+(2.021), (I-749)+(1.001)+(2.022), (I-749)+(1.001)+(2.023), (I-749)+(1.001)+(2.024), (I-749)+(1.001)+(2.025), (I-749)+(1.001)+(2.026), (I-749)+(1.001)+(2.027), (I-749)+(1.001)+(2.028), (I-749)+(1.001)+(2.029), (I-749)+(1.001)+(2.030), (I-749)+(1.001)+(2.031), (I-749)+(1.001)+(2.032), (I-749)+(1.001)+(2.033), (I-749)+(1.001)+(2.034), (I-749)+(1.001)+(2.035), (I-749)+(1.001)+(2.036), (I-749)+(1.001)+(2.037), (I-749)+(1.001)+(2.038), (I-749)+(1.001)+(2.039), (I-749)+(1.001)+(2.040), (I-749)+(1.001)+(2.041), (I-749)+(1.001)+(2.042), (I-749)+(1.001)+(2.043), (I-749)+(1.001)+(2.044), (I-749)+(1.001)+(2.045), (I-749)+(1.001)+(2.046), (I-749)+(1.001)+(2.047), (I-749)+(1.001)+(2.048), (I-749)+(1.001)+(2.049), (I-749)+(1.001)+(2.050), (I-749)+(1.001)+(2.051), (I-749)+(1.001)+(2.052), (I-749)+(1.001)+(2.053), (I-749)+(1.001)+(2.054), (I-749)+(1.001)+(2.055), (I-749)+(1.001)+(2.056), (I-749)+(1.001)+(2.057), (I-749)+(1.001)+(2.058), (I-749)+(1.001)+(2.059), (I-749)+(1.001)+(3.001), (I-749)+(1.001)+(3.002), (I-749)+(1.001)+(3.003), (I-749)+(1.001)+(3.004), (I-749)+(1.001)+(3.005), (I-749)+(1.001)+(3.006), (I-749)+(1.001)+(3.007), (I-749)+(1.001)+(3.008), (I-749)+(1.001)+(3.009), (I-749)+(1.001)+(3.010), (I-749)+(1.001)+(3.011), (I-749)+(1.001)+(3.012), (I-749)+(1.001)+(3.013), (I-749)+(1.001)+(3.014), (I-749)+(1.001)+(3.015), (I-749)+(1.001)+(3.016), (I-749)+(1.001)+(3.017), (I-749)+(1.001)+(3.018), (I-749)+(1.001)+(3.019), (I-749)+(1.001)+(3.020), (I-749)+(1.001)+(3.021), (I-749)+(1.001)+(3.022), (I-749)+(1.001)+(3.023), (I-749)+(1.001)+(3.024), (I-749)+(1.001)+(3.025), (I-749)+(1.001)+(3.026), (I-749)+(1.001)+(3.027), (I-749)+(1.001)+(3.028), (I-749)+(1.001)+(3.029), (I-749)+(1.001)+(3.030), (I-749)+(1.001)+(3.031), (I-749)+(1.001)+(5.001), (I-749)+(1.001)+(5.002), (I-749)+(1.001)+(5.003), (I-749)+(1.001)+(5.004), (I-749)+(1.001)+(5.005), (I-749)+(1.001)+(5.006), (I-749)+(1.001)+(5.007), (I-749)+(1.001)+(5.008), (I-749)+(1.001)+(5.009), (I-749)+(1.001)+(5.010), (I-749)+(1.001)+(5.011), (I-749)+(1.001)+(5.012), (I-749)+(1.001)+(5.013), (I-749)+(1.001)+(5.014), (I-749)+(1.001)+(5.015), (I-749)+(1.001)+(5.016), (I-749)+(1.001)+(5.017), (I-749)+(1.001)+(5.018), (I-749)+(1.001)+(5.019), (I-749)+(1.001)+(5.020), (I-749)+(1.001)+(5.021), (I-749)+(1.001)+(5.022), (I-749)+(1.001)+(5.023), (I-749)+(1.001)+(6.001), (I-749)+(1.001)+(6.002), (I-749)+(1.001)+(6.003), (I-749)+(1.001)+(6.004), (I-749)+(1.001)+(7.001), (I-749)+(1.001)+(7.002), (I-749)+(1.001)+(7.003), (I-749)+(1.001)+(7.004), (I-749)+(1.001)+(7.005), (I-749)+(1.001)+(7.006), (I-749)+(1.001)+(9.001), (I-749)+(1.001)+(9.002), (I-749)+(1.001)+(9.003), (I-749)+(1.001)+(9.004), (I-749)+(1.001)+(9.005), (I-749)+(1.001)+(9.006), (I-749)+(1.001)+(9.007), (I-749)+(1.001)+(9.008), (I-749)+(1.001)+(9.009), (I-749)+(1.001)+(14.001), (I-749)+(1.001)+(14.002), (I-749)+(1.001)+(15.008), (I-749)+(1.001)+(15.011), (I-749)+(1.001)+(15.012), (I-749)+(1.001)+(15.016), (I-749)+(1.001)+(15.025), (I-749)+(1.001)+(15.027), (I-749)+(1.001)+(15.047), (I-749)+(1.001)+(15.063), (I-749)+(1.001)+(15.064), (I-749)+(1.001)+(16.001), (I-749)+(1.001)+(16.002), (I-749)+(1.001)+(16.003), (I-749)+(1.001)+(16.004), (I-749)+(1.001)+(16.005), (I-749)+(1.001)+(16.006), (I-749)+(1.001)+(16.007), (I-749)+(1.001)+(16.008), (I-749)+(1.001)+(17.001), (I-749)+(1.001)+(17.002), (I-749)+(1.001)+(17.003), (I-749)+(1.001)+(17.004), (I-749)+(1.001)+(17.005), (I-749)+(1.001)+(17.006), (I-749)+(1.001)+(17.007), (I-749)+(1.001)+(17.008), (I-749)+(1.001)+(17.009), (I-749)+(1.001)+(17.010), (I-749)+(1.001)+(17.011), (I-749)+(1.001)+(17.012), (I-749)+(1.001)+(18.001),

(I-749)+(1.002)+(1.003), (I-749)+(1.002)+(1.004), (I-749)+(1.002)+(1.005), (I-749)+(1.002)+(1.006), (I-749)+(1.002)+(1.007), (I-749)+(1.002)+(1.008), (I-749)+(1.002)+(1.009), (I-749)+(1.002)+(1.010), (I-749)+(1.002)+(1.011), (I-749)+(1.002)+(1.012), (I-749)+(1.002)+(1.013), (I-749)+(1.002)+(1.014), (I-749)+(1.002)+(1.015), (I-749)+(1.002)+(1.016), (I-749)+(1.002)+(1.017), (I-749)+(1.002)+(1.018), (I-749)+(1.002)+(1.019), (I-749)+(1.002)+(1.020), (I-749)+(1.002)+(1.021), (I-749)+(1.002)+(1.022), (I-749)+(1.002)+(1.023), (I-749)+(1.002)+(1.024), (I-749)+(1.002)+(1.025), (I-749)+(1.002)+(1.026), (I-749)+(1.002)+(1.027), (I-749)+(1.002)+(1.028), (I-749)+(1.002)+(1.029), (I-749)+(1.002)+(1.030), (I-749)+(1.002)+(1.031), (I-749)+(1.002)+(1.032), (I-749)+(1.002)+(1.033), (I-749)+(1.002)+(1.034), (I-749)+(1.002)+(1.035), (I-749)+(1.002)+(1.036), (I-749)+(1.002)+(1.037), (I-749)+(1.002)+(1.038), (I-749)+(1.002)+(1.039), (I-749)+(1.002)+(1.040), (I-749)+(1.002)+(1.041), (I-749)+(1.002)+(1.042), (I-749)+(1.002)+(1.043), (I-749)+(1.002)+(1.044), (I-749)+(1.002)+(1.045), (I-749)+(1.002)+(1.046), (I-749)+(1.002)+(1.047), (I-749)+(1.002)+(1.048), (I-749)+(1.002)+(1.049), (I-749)+(1.002)+(1.050), (I-749)+(1.002)+(1.051), (I-749)+(1.002)+(1.052), (I-749)+(1.002)+(1.053), (I-749)+(1.002)+(1.054), (I-749)+(1.002)+(1.055), (I-749)+(1.002)+(1.056), (I-749)+(1.002)+(1.057), (I-749)+(1.002)+(1.058), (I-749)+(1.002)+(1.059), (I-749)+(1.002)+(1.060), (I-749)+(1.002)+(1.061), (I-749)+(1.002)+(1.062), (I-749)+(1.002)+(1.063), (I-749)+(1.002)+(1.064), (I-749)+(1.002)+(1.065), (I-749)+(1.002)+(1.066), (I-749)+(1.002)+(1.067), (I-749)+(1.002)+(1.068), (I-749)+(1.002)+(1.069), (I-749)+(1.002)+(1.070), (I-749)+(1.002)+(1.071), (I-749)+(1.002)+(1.072), (I-749)+(1.002)+(1.073), (I-749)+(1.002)+(1.074), (I-749)+(1.002)+(1.075), (I-749)+(1.002)+(1.076), (I-749)+(1.002)+(1.077), (I-749)+(1.002)+(1.078), (I-749)+(1.002)+(1.079), (I-749)+(1.002)+(1.080), (I-749)+(1.002)+(1.081), (I-749)+(1.002)+(1.082), (I-749)+(1.002)+(1.083), (I-749)+(1.002)+(1.084), (I-749)+(1.002)+(1.085), (I-749)+(1.002)+(1.086), (I-749)+(1.002)+(1.087), (I-749)+(1.002)+(1.088), (I-749)+(1.002)+(1.089), (I-749)+(1.002)+(1.090), (I-749)+(1.002)+(1.091), (I-749)+(1.002)+(1.092), (I-749)+(1.002)+(2.001), (I-749)+(1.002)+(2.002), (I-749)+(1.002)+(2.003), (I-749)+(1.002)+(2.004), (I-749)+(1.002)+(2.005), (I-749)+(1.002)+(2.006), (I-749)+(1.002)+(2.007), (I-749)+(1.002)+(2.008), (I-749)+(1.002)+(2.009), (I-749)+(1.002)+(2.010), (I-749)+(1.002)+(2.011), (I-749)+(1.002)+(2.012), (I-749)+(1.002)+(2.013), (I-749)+(1.002)+(2.014), (I-749)+(1.002)+(2.015), (I-749)+(1.002)+(2.016), (I-749)+(1.002)+(2.017), (I-749)+(1.002)+(2.018), (I-749)+(1.002)+(2.019), (I-749)+(1.002)+(2.020), (I-749)+(1.002)+(2.021), (I-749)+(1.002)+(2.022), (I-749)+(1.002)+(2.023), (I-749)+(1.002)+(2.024), (I-749)+(1.002)+(2.025), (I-749)+(1.002)+(2.026), (I-749)+(1.002)+(2.027), (I-749)+(1.002)+(2.028), (I-749)+(1.002)+(2.029), (I-749)+(1.002)+(2.030), (I-749)+(1.002)+(2.031), (I-749)+(1.002)+(2.032), (I-749)+(1.002)+(2.033), (I-749)+(1.002)+(2.034), (I-749)+(1.002)+(2.035), (I-749)+(1.002)+(2.036), (I-749)+(1.002)+(2.037), (I-749)+(1.002)+(2.038), (I-749)+(1.002)+(2.039), (I-749)+(1.002)+(2.040), (I-749)+(1.002)+(2.041), (I-749)+(1.002)+(2.042), (I-749)+(1.002)+(2.043), (I-749)+(1.002)+(2.044), (I-749)+(1.002)+(2.045), (I-749)+(1.002)+(2.046), (I-749)+(1.002)+(2.047), (I-749)+(1.002)+(2.048), (I-749)+(1.002)+(2.049), (I-749)+(1.002)+(2.050), (I-749)+(1.002)+(2.051), (I-749)+(1.002)+(2.052), (I-749)+(1.002)+(2.053), (I-749)+(1.002)+(2.054), (I-749)+(1.002)+(2.055), (I-749)+(1.002)+(2.056), (I-749)+(1.002)+(2.057), (I-749)+(1.002)+(2.058), (I-749)+(1.002)+(2.059), (I-749)+(1.002)+(3.001), (I-749)+(1.002)+(3.002), (I-749)+(1.002)+(3.003), (I-749)+(1.002)+(3.004), (I-749)+(1.002)+(3.005), (I-749)+(1.002)+(3.006), (I-749)+(1.002)+(3.007), (I-749)+(1.002)+(3.008), (I-749)+(1.002)+(3.009), (I-749)+(1.002)+(3.010), (I-749)+(1.002)+(3.011), (I-749)+(1.002)+(3.012), (I-749)+(1.002)+(3.013), (I-749)+(1.002)+(3.014), (I-749)+(1.002)+(3.015), (I-749)+(1.002)+(3.016), (I-749)+(1.002)+(3.017), (I-749)+(1.002)+(3.018), (I-749)+(1.002)+(3.019), (I-749)+(1.002)+(3.020), (I-749)+(1.002)+(3.021), (I-749)+(1.002)+(3.022), (I-749)+(1.002)+(3.023), (I-749)+(1.002)+(3.024), (I-749)+(1.002)+(3.025), (I-749)+(1.002)+(3.026), (I-749)+(1.002)+(3.027), (I-749)+(1.002)+(3.028), (I-749)+(1.002)+(3.029), (I-749)+(1.002)+(3.030), (I-749)+(1.002)+(3.031), (I-749)+(1.002)+(5.001), (I-749)+(1.002)+(5.002), (I-749)+(1.002)+(5.003), (I-749)+(1.002)+(5.004), (I-749)+(1.002)+(5.005), (I-749)+(1.002)+(5.006), (I-749)+(1.002)+(5.007), (I-749)+(1.002)+(5.008), (I-749)+(1.002)+(5.009), (I-749)+(1.002)+(5.010), (I-749)+(1.002)+(5.011), (I-749)+(1.002)+(5.012), (I-749)+(1.002)+(5.013), (I-749)+(1.002)+(5.014), (I-749)+(1.002)+(5.015), (I-749)+(1.002)+(5.016), (I-749)+(1.002)+(5.017), (I-749)+(1.002)+(5.018), (I-749)+(1.002)+(5.019), (I-749)+(1.002)+(5.020), (I-749)+(1.002)+(5.021), (I-749)+(1.002)+(5.022), (I-749)+(1.002)+(5.023), (I-749)+(1.002)+(6.001), (I-749)+(1.002)+(6.002), (I-749)+(1.002)+(6.003), (I-749)+(1.002)+(6.004), (I-749)+(1.002)+(7.001), (I-749)+(1.002)+(7.002), (I-749)+(1.002)+(7.003), (I-749)+(1.002)+(7.004), (I-749)+(1.002)+(7.005), (I-749)+(1.002)+(7.006), (I-749)+(1.002)+(9.001), (I-749)+(1.002)+(9.002), (I-749)+(1.002)+(9.003), (I-749)+(1.002)+(9.004), (I-749)+(1.002)+(9.005), (I-749)+(1.002)+(9.006), (I-749)+(1.002)+(9.007), (I-749)+(1.002)+(9.008), (I-749)+(1.002)+(9.009), (I-749)+(1.002)+(14.001), (I-749)+(1.002)+(14.002), (I-749)+(1.002)+(15.008), (I-749)+(1.002)+(15.011), (I-749)+(1.002)+(15.012), (I-749)+(1.002)+(15.016), (I-749)+(1.002)+(15.025), (I-749)+(1.002)+(15.027), (I-749)+(1.002)+(15.047), (I-749)+(1.002)+(15.063), (I-749)+(1.002)+(15.064), (I-749)+(1.002)+(16.001), (I-749)+(1.002)+(16.002), (I-749)+(1.002)+(16.003), (I-749)+(1.002)+(16.004), (I-749)+(1.002)+(16.005), (I-749)+(1.002)+(16.006), (I-749)+(1.002)+(16.007), (I-749)+(1.002)+(16.008), (I-749)+(1.002)+(17.001), (I-749)+(1.002)+(17.002), (I-749)+(1.002)+(17.003), (I-749)+(1.002)+(17.004), (I-749)+(1.002)+(17.005), (I-749)+(1.002)+(17.006), (I-749)+(1.002)+(17.007), (I-749)+(1.002)+(17.008), (I-749)+(1.002)+(17.009), (I-749)+(1.002)+(17.010), (I-749)+(1.002)+(17.011), (I-749)+(1.002)+(17.012), (I-749)+(1.002)+(18.001),

(I-749)+(1.003)+(1.004), (I-749)+(1.003)+(1.005), (I-749)+(1.003)+(1.006), (I-749)+(1.003)+(1.007), (I-749)+(1.003)+(1.008), (I-749)+(1.003)+(1.009), (I-749)+(1.003)+(1.010), (I-749)+(1.003)+(1.011), (I-749)+(1.003)+(1.012), (I-749)+(1.003)+(1.013), (I-749)+(1.003)+(1.014), (I-749)+(1.003)+(1.015), (I-749)+(1.003)+(1.016), (I-749)+(1.003)+(1.017), (I-749)+(1.003)+(1.018), (I-749)+(1.003)+(1.019), (I-749)+(1.003)+(1.020), (I-749)+(1.003)+(1.021), (I-749)+(1.003)+(1.022), (I-749)+(1.003)+(1.023), (I-749)+(1.003)+(1.024), (I-749)+(1.003)+(1.025), (I-749)+(1.003)+(1.026), (I-749)+(1.003)+(1.027), (I-749)+(1.003)+(1.028), (I-749)+(1.003)+(1.029), (I-749)+(1.003)+(1.030), (I-749)+(1.003)+(1.031), (I-749)+(1.003)+(1.032), (I-749)+(1.003)+(1.033), (I-749)+(1.003)+(1.034), (I-749)+(1.003)+(1.035), (I-749)+(1.003)+(1.036), (I-749)+(1.003)+(1.037), (I-749)+(1.003)+(1.038), (I-749)+(1.003)+(1.039), (I-749)+(1.003)+(1.040), (I-749)+(1.003)+(1.041), (I-749)+(1.003)+(1.042), (I-749)+(1.003)+(1.043), (I-749)+(1.003)+(1.044), (I-749)+(1.003)+(1.045), (I-749)+(1.003)+(1.046), (I-749)+(1.003)+(1.047), (I-749)+(1.003)+(1.048), (I-749)+(1.003)+(1.049), (I-749)+(1.003)+(1.050), (I-749)+(1.003)+(1.051), (I-749)+(1.003)+(1.052), (I-749)+(1.003)+(1.053), (I-749)+(1.003)+(1.054), (I-749)+(1.003)+(1.055), (I-749)+(1.003)+(1.056), (I-749)+(1.003)+(1.057), (I-749)+(1.003)+(1.058), (I-749)+(1.003)+(1.059), (I-749)+(1.003)+(1.060), (I-749)+(1.003)+(1.061), (I-749)+(1.003)+(1.062), (I-749)+(1.003)+(1.063), (I-749)+(1.003)+(1.064), (I-749)+(1.003)+(1.065), (I-749)+(1.003)+(1.066), (I-749)+(1.003)+(1.067), (I-749)+(1.003)+(1.068), (I-749)+(1.003)+(1.069), (I-749)+(1.003)+(1.070), (I-749)+(1.003)+(1.071), (I-749)+(1.003)+(1.072), (I-749)+(1.003)+(1.073), (I-749)+(1.003)+(1.074), (I-749)+(1.003)+(1.075), (I-749)+(1.003)+(1.076), (I-749)+(1.003)+(1.077), (I-749)+(1.003)+(1.078), (I-749)+(1.003)+(1.079), (I-749)+(1.003)+(1.080), (I-749)+(1.003)+(1.081), (I-749)+(1.003)+(1.082), (I-749)+(1.003)+(1.083), (I-749)+(1.003)+(1.084), (I-749)+(1.003)+(1.085), (I-749)+(1.003)+(1.086), (I-749)+(1.003)+(1.087), (I-749)+(1.003)+(1.088), (I-749)+(1.003)+(1.089), (I-749)+(1.003)+(1.090), (I-749)+(1.003)+(1.091), (I-749)+(1.003)+(1.092), (I-749)+(1.003)+(2.001), (I-749)+(1.003)+(2.002), (I-749)+(1.003)+(2.003), (I-749)+(1.003)+(2.004), (I-749)+(1.003)+(2.005), (I-749)+(1.003)+(2.006), (I-749)+(1.003)+(2.007), (I-749)+(1.003)+(2.008), (I-749)+(1.003)+(2.009), (I-749)+(1.003)+(2.010), (I-749)+(1.003)+(2.011), (I-749)+(1.003)+(2.012), (I-749)+(1.003)+(2.013), (I-749)+(1.003)+(2.014), (I-749)+(1.003)+(2.015), (I-749)+(1.003)+(2.016), (I-749)+(1.003)+(2.017), (I-749)+(1.003)+(2.018), (I-749)+(1.003)+(2.019), (I-749)+(1.003)+(2.020), (I-749)+(1.003)+(2.021), (I-749)+(1.003)+(2.022), (I-749)+(1.003)+(2.023), (I-749)+(1.003)+(2.024), (I-749)+(1.003)+(2.025), (I-749)+(1.003)+(2.026), (I-749)+(1.003)+(2.027), (I-749)+(1.003)+(2.028), (I-749)+(1.003)+(2.029), (I-749)+(1.003)+(2.030), (I-749)+(1.003)+(2.031), (I-749)+(1.003)+(2.032), (I-749)+(1.003)+(2.033), (I-749)+(1.003)+(2.034), (I-749)+(1.003)+(2.035), (I-749)+(1.003)+(2.036), (I-749)+(1.003)+(2.037), (I-749)+(1.003)+(2.038), (I-749)+(1.003)+(2.039), (I-749)+(1.003)+(2.040), (I-749)+(1.003)+(2.041), (I-749)+(1.003)+(2.042), (I-749)+(1.003)+(2.043), (I-749)+(1.003)+(2.044), (I-749)+(1.003)+(2.045), (I-749)+(1.003)+(2.046), (I-749)+(1.003)+(2.047), (I-749)+(1.003)+(2.048), (I-749)+(1.003)+(2.049), (I-749)+(1.003)+(2.050), (I-749)+(1.003)+(2.051), (I-749)+(1.003)+(2.052), (I-749)+(1.003)+(2.053), (I-749)+(1.003)+(2.054), (I-749)+(1.003)+(2.055), (I-749)+(1.003)+(2.056), (I-749)+(1.003)+(2.057), (I-749)+(1.003)+(2.058), (I-749)+(1.003)+(2.059), (I-749)+(1.003)+(3.001), (I-749)+(1.003)+(3.002), (I-749)+(1.003)+(3.003), (I-749)+(1.003)+(3.004), (I-749)+(1.003)+(3.005), (I-749)+(1.003)+(3.006), (I-749)+(1.003)+(3.007), (I-749)+(1.003)+(3.008), (I-749)+(1.003)+(3.009), (I-749)+(1.003)+(3.010), (I-749)+(1.003)+(3.011), (I-749)+(1.003)+(3.012), (I-749)+(1.003)+(3.013), (I-749)+(1.003)+(3.014), (I-749)+(1.003)+(3.015), (I-749)+(1.003)+(3.016), (I-749)+(1.003)+(3.017), (I-749)+(1.003)+(3.018), (I-749)+(1.003)+(3.019), (I-749)+(1.003)+(3.020), (I-749)+(1.003)+(3.021), (I-749)+(1.003)+(3.022), (I-749)+(1.003)+(3.023), (I-749)+(1.003)+(3.024), (I-749)+(1.003)+(3.025), (I-749)+(1.003)+(3.026), (I-749)+(1.003)+(3.027), (I-749)+(1.003)+(3.028), (I-749)+(1.003)+(3.029), (I-749)+(1.003)+(3.030), (I-749)+(1.003)+(3.031), (I-749)+(1.003)+(5.001), (I-749)+(1.003)+(5.002), (I-749)+(1.003)+(5.003), (I-749)+(1.003)+(5.004), (I-749)+(1.003)+(5.005), (I-749)+(1.003)+(5.006), (I-749)+(1.003)+(5.007), (I-749)+(1.003)+(5.008), (I-749)+(1.003)+(5.009), (I-749)+(1.003)+(5.010), (I-749)+(1.003)+(5.011), (I-749)+(1.003)+(5.012), (I-749)+(1.003)+(5.013), (I-749)+(1.003)+(5.014), (I-749)+(1.003)+(5.015), (I-749)+(1.003)+(5.016), (I-749)+(1.003)+(5.017), (I-749)+(1.003)+(5.018), (I-749)+(1.003)+(5.019), (I-749)+(1.003)+(5.020), (I-749)+(1.003)+(5.021), (I-749)+(1.003)+(5.022), (I-749)+(1.003)+(5.023), (I-749)+(1.003)+(6.001), (I-749)+(1.003)+(6.002), (I-749)+(1.003)+(6.003), (I-749)+(1.003)+(6.004), (I-749)+(1.003)+(7.001), (I-749)+(1.003)+(7.002), (I-749)+(1.003)+(7.003), (I-749)+(1.003)+(7.004), (I-749)+(1.003)+(7.005), (I-749)+(1.003)+(7.006), (I-749)+(1.003)+(9.001), (I-749)+(1.003)+(9.002), (I-749)+(1.003)+(9.003), (I-749)+(1.003)+(9.004), (I-749)+(1.003)+(9.005), (I-749)+(1.003)+(9.006), (I-749)+(1.003)+(9.007), (I-749)+(1.003)+(9.008), (I-749)+(1.003)+(9.009), (I-749)+(1.003)+(14.001), (I-749)+(1.003)+(14.002), (I-749)+(1.003)+(15.008), (I-749)+(1.003)+(15.011), (I-749)+(1.003)+(15.012), (I-749)+(1.003)+(15.016), (I-749)+(1.003)+(15.025), (I-749)+(1.003)+(15.027), (I-749)+(1.003)+(15.047), (I-749)+(1.003)+(15.063), (I-749)+(1.003)+(15.064), (I-749)+(1.003)+(16.001), (I-749)+(1.003)+(16.002), (I-749)+(1.003)+(16.003), (I-749)+(1.003)+(16.004), (I-749)+(1.003)+(16.005), (I-749)+(1.003)+(16.006), (I-749)+(1.003)+(16.007), (I-749)+(1.003)+(16.008), (I-749)+(1.003)+(17.001), (I-749)+(1.003)+(17.002), (I-749)+(1.003)+(17.003), (I-749)+(1.003)+(17.004), (I-749)+(1.003)+(17.005), (I-749)+(1.003)+(17.006), (I-749)+(1.003)+(17.007), (I-749)+(1.003)+(17.008), (I-749)+(1.003)+(17.009), (I-749)+(1.003)+(17.010), (I-749)+(1.003)+(17.011), (I-749)+(1.003)+(17.012), (I-749)+(1.003)+(18.001),

(I-749)+(1.004)+(1.005), (I-749)+(1.004)+(1.006), (I-749)+(1.004)+(1.007), (I-749)+(1.004)+(1.008), (I-749)+(1.004)+(1.009), (I-749)+(1.004)+(1.010), (I-749)+(1.004)+(1.011), (I-749)+(1.004)+(1.012), (I-749)+(1.004)+(1.013), (I-749)+(1.004)+(1.014), (I-749)+(1.004)+(1.015), (I-749)+(1.004)+(1.016), (I-749)+(1.004)+(1.017), (I-749)+(1.004)+(1.018), (I-749)+(1.004)+(1.019), (I-749)+(1.004)+(1.020), (I-749)+(1.004)+(1.021), (I-749)+(1.004)+(1.022), (I-749)+(1.004)+(1.023), (I-749)+(1.004)+(1.024), (I-749)+(1.004)+(1.025), (I-749)+(1.004)+(1.026), (I-749)+(1.004)+(1.027), (I-749)+(1.004)+(1.028), (I-749)+(1.004)+(1.029), (I-749)+(1.004)+(1.030), (I-749)+(1.004)+(1.031), (I-749)+(1.004)+(1.032), (I-749)+(1.004)+(1.033), (I-749)+(1.004)+(1.034), (I-749)+(1.004)+(1.035), (I-749)+(1.004)+(1.036), (I-749)+(1.004)+(1.037), (I-749)+(1.004)+(1.038), (I-749)+(1.004)+(1.039), (I-749)+(1.004)+(1.040), (I-749)+(1.004)+(1.041), (I-749)+(1.004)+(1.042), (I-749)+(1.004)+(1.043), (I-749)+(1.004)+(1.044), (I-749)+(1.004)+(1.045), (I-749)+(1.004)+(1.046), (I-749)+(1.004)+(1.047), (I-749)+(1.004)+(1.048), (I-749)+(1.004)+(1.049), (I-749)+(1.004)+(1.050), (I-749)+(1.004)+(1.051), (I-749)+(1.004)+(1.052), (I-749)+(1.004)+(1.053), (I-749)+(1.004)+(1.054), (I-749)+(1.004)+(1.055), (I-749)+(1.004)+(1.056), (I-749)+(1.004)+(1.057), (I-749)+(1.004)+(1.058), (I-749)+(1.004)+(1.059), (I-749)+(1.004)+(1.060), (I-749)+(1.004)+(1.061), (I-749)+(1.004)+(1.062), (I-749)+(1.004)+(1.063), (I-749)+(1.004)+(1.064), (I-749)+(1.004)+(1.065), (I-749)+(1.004)+(1.066), (I-749)+(1.004)+(1.067), (I-749)+(1.004)+(1.068), (I-749)+(1.004)+(1.069), (I-749)+(1.004)+(1.070), (I-749)+(1.004)+(1.071), (I-749)+(1.004)+(1.072), (I-749)+(1.004)+(1.073), (I-749)+(1.004)+(1.074), (I-749)+(1.004)+(1.075), (I-749)+(1.004)+(1.076), (I-749)+(1.004)+(1.077), (I-749)+(1.004)+(1.078), (I-749)+(1.004)+(1.079), (I-749)+(1.004)+(1.080), (I-749)+(1.004)+(1.081), (I-749)+(1.004)+(1.082), (I-749)+(1.004)+(1.083), (I-749)+(1.004)+(1.084), (I-749)+(1.004)+(1.085), (I-749)+(1.004)+(1.086), (I-749)+(1.004)+(1.087), (I-749)+(1.004)+(1.088), (I-749)+(1.004)+(1.089), (I-749)+(1.004)+(1.090), (I-749)+(1.004)+(1.091), (I-749)+(1.004)+(1.092), (I-749)+(1.004)+(2.001), (I-749)+(1.004)+(2.002), (I-749)+(1.004)+(2.003), (I-749)+(1.004)+(2.004), (I-749)+(1.004)+(2.005), (I-749)+(1.004)+(2.006), (I-749)+(1.004)+(2.007), (I-749)+(1.004)+(2.008), (I-749)+(1.004)+(2.009), (I-749)+(1.004)+(2.010), (I-749)+(1.004)+(2.011), (I-749)+(1.004)+(2.012), (I-749)+(1.004)+(2.013), (I-749)+(1.004)+(2.014), (I-749)+(1.004)+(2.015), (I-749)+(1.004)+(2.016), (I-749)+(1.004)+(2.017), (I-749)+(1.004)+(2.018), (I-749)+(1.004)+(2.019), (I-749)+(1.004)+(2.020), (I-749)+(1.004)+(2.021), (I-749)+(1.004)+(2.022), (I-749)+(1.004)+(2.023), (I-749)+(1.004)+(2.024), (I-749)+(1.004)+(2.025), (I-749)+(1.004)+(2.026), (I-749)+(1.004)+(2.027), (I-749)+(1.004)+(2.028), (I-749)+(1.004)+(2.029), (I-749)+(1.004)+(2.030), (I-749)+(1.004)+(2.031), (I-749)+(1.004)+(2.032), (I-749)+(1.004)+(2.033), (I-749)+(1.004)+(2.034), (I-749)+(1.004)+(2.035), (I-749)+(1.004)+(2.036), (I-749)+(1.004)+(2.037), (I-749)+(1.004)+(2.038), (I-749)+(1.004)+(2.039), (I-749)+(1.004)+(2.040), (I-749)+(1.004)+(2.041), (I-749)+(1.004)+(2.042), (I-749)+(1.004)+(2.043), (I-749)+(1.004)+(2.044), (I-749)+(1.004)+(2.045), (I-749)+(1.004)+(2.046), (I-749)+(1.004)+(2.047), (I-749)+(1.004)+(2.048), (I-749)+(1.004)+(2.049), (I-749)+(1.004)+(2.050), (I-749)+(1.004)+(2.051), (I-749)+(1.004)+(2.052), (I-749)+(1.004)+(2.053), (I-749)+(1.004)+(2.054), (I-749)+(1.004)+(2.055), (I-749)+(1.004)+(2.056), (I-749)+(1.004)+(2.057), (I-749)+(1.004)+(2.058), (I-749)+(1.004)+(2.059), (I-749)+(1.004)+(3.001), (I-749)+(1.004)+(3.002), (I-749)+(1.004)+(3.003), (I-749)+(1.004)+(3.004), (I-749)+(1.004)+(3.005), (I-749)+(1.004)+(3.006), (I-749)+(1.004)+(3.007), (I-749)+(1.004)+(3.008), (I-749)+(1.004)+(3.009), (I-749)+(1.004)+(3.010), (I-749)+(1.004)+(3.011), (I-749)+(1.004)+(3.012), (I-749)+(1.004)+(3.013), (I-749)+(1.004)+(3.014), (I-749)+(1.004)+(3.015), (I-749)+(1.004)+(3.016), (I-749)+(1.004)+(3.017), (I-749)+(1.004)+(3.018), (I-749)+(1.004)+(3.019), (I-749)+(1.004)+(3.020), (I-749)+(1.004)+(3.021), (I-749)+(1.004)+(3.022), (I-749)+(1.004)+(3.023), (I-749)+(1.004)+(3.024), (I-749)+(1.004)+(3.025), (I-749)+(1.004)+(3.026), (I-749)+(1.004)+(3.027), (I-749)+(1.004)+(3.028), (I-749)+(1.004)+(3.029), (I-749)+(1.004)+(3.030), (I-749)+(1.004)+(3.031), (I-749)+(1.004)+(5.001), (I-749)+(1.004)+(5.002), (I-749)+(1.004)+(5.003), (I-749)+(1.004)+(5.004), (I-749)+(1.004)+(5.005), (I-749)+(1.004)+(5.006), (I-749)+(1.004)+(5.007), (I-749)+(1.004)+(5.008), (I-749)+(1.004)+(5.009), (I-749)+(1.004)+(5.010), (I-749)+(1.004)+(5.011), (I-749)+(1.004)+(5.012), (I-749)+(1.004)+(5.013), (I-749)+(1.004)+(5.014), (I-749)+(1.004)+(5.015), (I-749)+(1.004)+(5.016), (I-749)+(1.004)+(5.017), (I-749)+(1.004)+(5.018), (I-749)+(1.004)+(5.019), (I-749)+(1.004)+(5.020), (I-749)+(1.004)+(5.021), (I-749)+(1.004)+(5.022), (I-749)+(1.004)+(5.023), (I-749)+(1.004)+(6.001), (I-749)+(1.004)+(6.002), (I-749)+(1.004)+(6.003), (I-749)+(1.004)+(6.004), (I-749)+(1.004)+(7.001), (I-749)+(1.004)+(7.002), (I-749)+(1.004)+(7.003), (I-749)+(1.004)+(7.004), (I-749)+(1.004)+(7.005), (I-749)+(1.004)+(7.006), (I-749)+(1.004)+(9.001), (I-749)+(1.004)+(9.002), (I-749)+(1.004)+(9.003), (I-749)+(1.004)+(9.004), (I-749)+(1.004)+(9.005), (I-749)+(1.004)+(9.006), (I-749)+(1.004)+(9.007), (I-749)+(1.004)+(9.008), (I-749)+(1.004)+(9.009), (I-749)+(1.004)+(14.001), (I-749)+(1.004)+(14.002), (I-749)+(1.004)+(15.008), (I-749)+(1.004)+(15.011), (I-749)+(1.004)+(15.012), (I-749)+(1.004)+(15.016), (I-749)+(1.004)+(15.025), (I-749)+(1.004)+(15.027), (I-749)+(1.004)+(15.047), (I-749)+(1.004)+(15.063), (I-749)+(1.004)+(15.064), (I-749)+(1.004)+(16.001), (I-749)+(1.004)+(16.002), (I-749)+(1.004)+(16.003), (I-749)+(1.004)+(16.004), (I-749)+(1.004)+(16.005), (I-749)+(1.004)+(16.006), (I-749)+(1.004)+(16.007), (I-749)+(1.004)+(16.008), (I-749)+(1.004)+(17.001), (I-749)+(1.004)+(17.002), (I-749)+(1.004)+(17.003), (I-749)+(1.004)+(17.004), (I-749)+(1.004)+(17.005), (I-749)+(1.004)+(17.006), (I-749)+(1.004)+(17.007), (I-749)+(1.004)+(17.008), (I-749)+(1.004)+(17.009), (I-749)+(1.004)+(17.010), (I-749)+(1.004)+(17.011), (I-749)+(1.004)+(17.012), (I-749)+(1.004)+(18.001),

(I-749)+(1.005)+(1.006), (I-749)+(1.005)+(1.007), (I-749)+(1.005)+(1.008), (I-749)+(1.005)+(1.009), (I-749)+(1.005)+(1.010), (I-749)+(1.005)+(1.011), (I-749)+(1.005)+(1.012), (I-749)+(1.005)+(1.013), (I-749)+(1.005)+(1.014), (I-749)+(1.005)+(1.015), (I-749)+(1.005)+(1.016), (I-749)+(1.005)+(1.017), (I-749)+(1.005)+(1.018), (I-749)+(1.005)+(1.019), (I-749)+(1.005)+(1.020), (I-749)+(1.005)+(1.021), (I-749)+(1.005)+(1.022), (I-749)+(1.005)+(1.023), (I-749)+(1.005)+(1.024), (I-749)+(1.005)+(1.025), (I-749)+(1.005)+(1.026), (I-749)+(1.005)+(1.027), (I-749)+(1.005)+(1.028), (I-749)+(1.005)+(1.029), (I-749)+(1.005)+(1.030), (I-749)+(1.005)+(1.031), (I-749)+(1.005)+(1.032), (I-749)+(1.005)+(1.033), (I-749)+(1.005)+(1.034), (I-749)+(1.005)+(1.035), (I-749)+(1.005)+(1.036), (I-749)+(1.005)+(1.037), (I-749)+(1.005)+(1.038), (I-749)+(1.005)+(1.039), (I-749)+(1.005)+(1.040), (I-749)+(1.005)+(1.041), (I-749)+(1.005)+(1.042), (I-749)+(1.005)+(1.043), (I-749)+(1.005)+(1.044), (I-749)+(1.005)+(1.045), (I-749)+(1.005)+(1.046), (I-749)+(1.005)+(1.047), (I-749)+(1.005)+(1.048), (I-749)+(1.005)+(1.049), (I-749)+(1.005)+(1.050), (I-749)+(1.005)+(1.051), (I-749)+(1.005)+(1.052), (I-749)+(1.005)+(1.053), (I-749)+(1.005)+(1.054), (I-749)+(1.005)+(1.055), (I-749)+(1.005)+(1.056), (I-749)+(1.005)+(1.057), (I-749)+(1.005)+(1.058), (I-749)+(1.005)+(1.059), (I-749)+(1.005)+(1.060), (I-749)+(1.005)+(1.061), (I-749)+(1.005)+(1.062), (I-749)+(1.005)+(1.063), (I-749)+(1.005)+(1.064), (I-749)+(1.005)+(1.065), (I-749)+(1.005)+(1.066), (I-749)+(1.005)+(1.067), (I-749)+(1.005)+(1.068), (I-749)+(1.005)+(1.069), (I-749)+(1.005)+(1.070), (I-749)+(1.005)+(1.071), (I-749)+(1.005)+(1.072), (I-749)+(1.005)+(1.073), (I-749)+(1.005)+(1.074), (I-749)+(1.005)+(1.075), (I-749)+(1.005)+(1.076), (I-749)+(1.005)+(1.077), (I-749)+(1.005)+(1.078), (I-749)+(1.005)+(1.079), (I-749)+(1.005)+(1.080), (I-749)+(1.005)+(1.081), (I-749)+(1.005)+(1.082), (I-749)+(1.005)+(1.083), (I-749)+(1.005)+(1.084), (I-749)+(1.005)+(1.085), (I-749)+(1.005)+(1.086), (I-749)+(1.005)+(1.087), (I-749)+(1.005)+(1.088), (I-749)+(1.005)+(1.089), (I-749)+(1.005)+(1.090), (I-749)+(1.005)+(1.091), (I-749)+(1.005)+(1.092), (I-749)+(1.005)+(2.001), (I-749)+(1.005)+(2.002), (I-749)+(1.005)+(2.003), (I-749)+(1.005)+(2.004), (I-749)+(1.005)+(2.005), (I-749)+(1.005)+(2.006), (I-749)+(1.005)+(2.007), (I-749)+(1.005)+(2.008), (I-749)+(1.005)+(2.009), (I-749)+(1.005)+(2.010), (I-749)+(1.005)+(2.011), (I-749)+(1.005)+(2.012), (I-749)+(1.005)+(2.013), (I-749)+(1.005)+(2.014), (I-749)+(1.005)+(2.015), (I-749)+(1.005)+(2.016), (I-749)+(1.005)+(2.017), (I-749)+(1.005)+(2.018), (I-749)+(1.005)+(2.019), (I-749)+(1.005)+(2.020), (I-749)+(1.005)+(2.021), (I-749)+(1.005)+(2.022), (I-749)+(1.005)+(2.023), (I-749)+(1.005)+(2.024), (I-749)+(1.005)+(2.025), (I-749)+(1.005)+(2.026), (I-749)+(1.005)+(2.027), (I-749)+(1.005)+(2.028), (I-749)+(1.005)+(2.029), (I-749)+(1.005)+(2.030), (I-749)+(1.005)+(2.031), (I-749)+(1.005)+(2.032), (I-749)+(1.005)+(2.033), (I-749)+(1.005)+(2.034), (I-749)+(1.005)+(2.035), (I-749)+(1.005)+(2.036), (I-749)+(1.005)+(2.037), (I-749)+(1.005)+(2.038), (I-749)+(1.005)+(2.039), (I-749)+(1.005)+(2.040), (I-749)+(1.005)+(2.041), (I-749)+(1.005)+(2.042), (I-749)+(1.005)+(2.043), (I-749)+(1.005)+(2.044), (I-749)+(1.005)+(2.045), (I-749)+(1.005)+(2.046), (I-749)+(1.005)+(2.047), (I-749)+(1.005)+(2.048), (I-749)+(1.005)+(2.049), (I-749)+(1.005)+(2.050), (I-749)+(1.005)+(2.051), (I-749)+(1.005)+(2.052), (I-749)+(1.005)+(2.053), (I-749)+(1.005)+(2.054), (I-749)+(1.005)+(2.055), (I-749)+(1.005)+(2.056), (I-749)+(1.005)+(2.057), (I-749)+(1.005)+(2.058), (I-749)+(1.005)+(2.059), (I-749)+(1.005)+(3.001), (I-749)+(1.005)+(3.002), (I-749)+(1.005)+(3.003), (I-749)+(1.005)+(3.004), (I-749)+(1.005)+(3.005), (I-749)+(1.005)+(3.006), (I-749)+(1.005)+(3.007), (I-749)+(1.005)+(3.008), (I-749)+(1.005)+(3.009), (I-749)+(1.005)+(3.010), (I-749)+(1.005)+(3.011), (I-749)+(1.005)+(3.012), (I-749)+(1.005)+(3.013), (I-749)+(1.005)+(3.014), (I-749)+(1.005)+(3.015), (I-749)+(1.005)+(3.016), (I-749)+(1.005)+(3.017), (I-749)+(1.005)+(3.018), (I-749)+(1.005)+(3.019), (I-749)+(1.005)+(3.020), (I-749)+(1.005)+(3.021), (I-749)+(1.005)+(3.022), (I-749)+(1.005)+(3.023), (I-749)+(1.005)+(3.024), (I-749)+(1.005)+(3.025), (I-749)+(1.005)+(3.026), (I-749)+(1.005)+(3.027), (I-749)+(1.005)+(3.028), (I-749)+(1.005)+(3.029), (I-749)+(1.005)+(3.030), (I-749)+(1.005)+(3.031), (I-749)+(1.005)+(5.001), (I-749)+(1.005)+(5.002), (I-749)+(1.005)+(5.003), (I-749)+(1.005)+(5.004), (I-749)+(1.005)+(5.005), (I-749)+(1.005)+(5.006), (I-749)+(1.005)+(5.007), (I-749)+(1.005)+(5.008), (I-749)+(1.005)+(5.009), (I-749)+(1.005)+(5.010), (I-749)+(1.005)+(5.011), (I-749)+(1.005)+(5.012), (I-749)+(1.005)+(5.013), (I-749)+(1.005)+(5.014), (I-749)+(1.005)+(5.015), (I-749)+(1.005)+(5.016), (I-749)+(1.005)+(5.017), (I-749)+(1.005)+(5.018), (I-749)+(1.005)+(5.019), (I-749)+(1.005)+(5.020), (I-749)+(1.005)+(5.021), (I-749)+(1.005)+(5.022), (I-749)+(1.005)+(5.023), (I-749)+(1.005)+(6.001), (I-749)+(1.005)+(6.002), (I-749)+(1.005)+(6.003), (I-749)+(1.005)+(6.004), (I-749)+(1.005)+(7.001), (I-749)+(1.005)+(7.002), (I-749)+(1.005)+(7.003), (I-749)+(1.005)+(7.004), (I-749)+(1.005)+(7.005), (I-749)+(1.005)+(7.006), (I-749)+(1.005)+(9.001), (I-749)+(1.005)+(9.002), (I-749)+(1.005)+(9.003), (I-749)+(1.005)+(9.004), (I-749)+(1.005)+(9.005), (I-749)+(1.005)+(9.006), (I-749)+(1.005)+(9.007), (I-749)+(1.005)+(9.008), (I-749)+(1.005)+(9.009), (I-749)+(1.005)+(14.001), (I-749)+(1.005)+(14.002), (I-749)+(1.005)+(15.008), (I-749)+(1.005)+(15.011), (I-749)+(1.005)+(15.012), (I-749)+(1.005)+(15.016), (I-749)+(1.005)+(15.025), (I-749)+(1.005)+(15.027), (I-749)+(1.005)+(15.047), (I-749)+(1.005)+(15.063), (I-749)+(1.005)+(15.064), (I-749)+(1.005)+(16.001), (I-749)+(1.005)+(16.002), (I-749)+(1.005)+(16.003), (I-749)+(1.005)+(16.004), (I-749)+(1.005)+(16.005), (I-749)+(1.005)+(16.006), (I-749)+(1.005)+(16.007), (I-749)+(1.005)+(16.008), (I-749)+(1.005)+(17.001), (I-749)+(1.005)+(17.002), (I-749)+(1.005)+(17.003), (I-749)+(1.005)+(17.004), (I-749)+(1.005)+(17.005), (I-749)+(1.005)+(17.006), (I-749)+(1.005)+(17.007), (I-749)+(1.005)+(17.008), (I-749)+(1.005)+(17.009), (I-749)+(1.005)+(17.010), (I-749)+(1.005)+(17.011), (I-749)+(1.005)+(17.012), (I-749)+(1.005)+(18.001),

(I-749)+(1.006)+(1.007), (I-749)+(1.006)+(1.008), (I-749)+(1.006)+(1.009), (I-749)+(1.006)+(1.010), (I-749)+(1.006)+(1.011), (I-749)+(1.006)+(1.012), (I-749)+(1.006)+(1.013), (I-749)+(1.006)+(1.014), (I-749)+(1.006)+(1.015), (I-749)+(1.006)+(1.016), (I-749)+(1.006)+(1.017), (I-749)+(1.006)+(1.018), (I-749)+(1.006)+(1.019), (I-749)+(1.006)+(1.020), (I-749)+(1.006)+(1.021), (I-749)+(1.006)+(1.022), (I-749)+(1.006)+(1.023), (I-749)+(1.006)+(1.024), (I-749)+(1.006)+(1.025), (I-749)+(1.006)+(1.026), (I-749)+(1.006)+(1.027), (I-749)+(1.006)+(1.028), (I-749)+(1.006)+(1.029), (I-749)+(1.006)+(1.030), (I-749)+(1.006)+(1.031), (I-749)+(1.006)+(1.032), (I-749)+(1.006)+(1.033), (I-749)+(1.006)+(1.034), (I-749)+(1.006)+(1.035), (I-749)+(1.006)+(1.036), (I-749)+(1.006)+(1.037), (I-749)+(1.006)+(1.038), (I-749)+(1.006)+(1.039), (I-749)+(1.006)+(1.040), (I-749)+(1.006)+(1.041), (I-749)+(1.006)+(1.042), (I-749)+(1.006)+(1.043), (I-749)+(1.006)+(1.044), (I-749)+(1.006)+(1.045), (I-749)+(1.006)+(1.046), (I-749)+(1.006)+(1.047), (I-749)+(1.006)+(1.048), (I-749)+(1.006)+(1.049), (I-749)+(1.006)+(1.050), (I-749)+(1.006)+(1.051), (I-749)+(1.006)+(1.052), (I-749)+(1.006)+(1.053), (I-749)+(1.006)+(1.054), (I-749)+(1.006)+(1.055), (I-749)+(1.006)+(1.056), (I-749)+(1.006)+(1.057), (I-749)+(1.006)+(1.058), (I-749)+(1.006)+(1.059), (I-749)+(1.006)+(1.060), (I-749)+(1.006)+(1.061), (I-749)+(1.006)+(1.062), (I-749)+(1.006)+(1.063), (I-749)+(1.006)+(1.064), (I-749)+(1.006)+(1.065), (I-749)+(1.006)+(1.066), (I-749)+(1.006)+(1.067), (I-749)+(1.006)+(1.068), (I-749)+(1.006)+(1.069), (I-749)+(1.006)+(1.070), (I-749)+(1.006)+(1.071), (I-749)+(1.006)+(1.072), (I-749)+(1.006)+(1.073), (I-749)+(1.006)+(1.074), (I-749)+(1.006)+(1.075), (I-749)+(1.006)+(1.076), (I-749)+(1.006)+(1.077), (I-749)+(1.006)+(1.078), (I-749)+(1.006)+(1.079), (I-749)+(1.006)+(1.080), (I-749)+(1.006)+(1.081), (I-749)+(1.006)+(1.082), (I-749)+(1.006)+(1.083), (I-749)+(1.006)+(1.084), (I-749)+(1.006)+(1.085), (I-749)+(1.006)+(1.086), (I-749)+(1.006)+(1.087), (I-749)+(1.006)+(1.088), (I-749)+(1.006)+(1.089), (I-749)+(1.006)+(1.090), (I-749)+(1.006)+(1.091), (I-749)+(1.006)+(1.092), (I-749)+(1.006)+(2.001), (I-749)+(1.006)+(2.002), (I-749)+(1.006)+(2.003), (I-749)+(1.006)+(2.004), (I-749)+(1.006)+(2.005), (I-749)+(1.006)+(2.006), (I-749)+(1.006)+(2.007), (I-749)+(1.006)+(2.008), (I-749)+(1.006)+(2.009), (I-749)+(1.006)+(2.010), (I-749)+(1.006)+(2.011), (I-749)+(1.006)+(2.012), (I-749)+(1.006)+(2.013), (I-749)+(1.006)+(2.014), (I-749)+(1.006)+(2.015), (I-749)+(1.006)+(2.016), (I-749)+(1.006)+(2.017), (I-749)+(1.006)+(2.018), (I-749)+(1.006)+(2.019), (I-749)+(1.006)+(2.020), (I-749)+(1.006)+(2.021), (I-749)+(1.006)+(2.022), (I-749)+(1.006)+(2.023), (I-749)+(1.006)+(2.024), (I-749)+(1.006)+(2.025), (I-749)+(1.006)+(2.026), (I-749)+(1.006)+(2.027), (I-749)+(1.006)+(2.028), (I-749)+(1.006)+(2.029), (I-749)+(1.006)+(2.030), (I-749)+(1.006)+(2.031), (I-749)+(1.006)+(2.032), (I-749)+(1.006)+(2.033), (I-749)+(1.006)+(2.034), (I-749)+(1.006)+(2.035), (I-749)+(1.006)+(2.036), (I-749)+(1.006)+(2.037), (I-749)+(1.006)+(2.038), (I-749)+(1.006)+(2.039), (I-749)+(1.006)+(2.040), (I-749)+(1.006)+(2.041), (I-749)+(1.006)+(2.042), (I-749)+(1.006)+(2.043), (I-749)+(1.006)+(2.044), (I-749)+(1.006)+(2.045), (I-749)+(1.006)+(2.046), (I-749)+(1.006)+(2.047), (I-749)+(1.006)+(2.048), (I-749)+(1.006)+(2.049), (I-749)+(1.006)+(2.050), (I-749)+(1.006)+(2.051), (I-749)+(1.006)+(2.052), (I-749)+(1.006)+(2.053), (I-749)+(1.006)+(2.054), (I-749)+(1.006)+(2.055), (I-749)+(1.006)+(2.056), (I-749)+(1.006)+(2.057), (I-749)+(1.006)+(2.058), (I-749)+(1.006)+(2.059), (I-749)+(1.006)+(3.001), (I-749)+(1.006)+(3.002), (I-749)+(1.006)+(3.003), (I-749)+(1.006)+(3.004), (I-749)+(1.006)+(3.005), (I-749)+(1.006)+(3.006), (I-749)+(1.006)+(3.007), (I-749)+(1.006)+(3.008), (I-749)+(1.006)+(3.009), (I-749)+(1.006)+(3.010), (I-749)+(1.006)+(3.011), (I-749)+(1.006)+(3.012), (I-749)+(1.006)+(3.013), (I-749)+(1.006)+(3.014), (I-749)+(1.006)+(3.015), (I-749)+(1.006)+(3.016), (I-749)+(1.006)+(3.017), (I-749)+(1.006)+(3.018), (I-749)+(1.006)+(3.019), (I-749)+(1.006)+(3.020), (I-749)+(1.006)+(3.021), (I-749)+(1.006)+(3.022), (I-749)+(1.006)+(3.023), (I-749)+(1.006)+(3.024), (I-749)+(1.006)+(3.025), (I-749)+(1.006)+(3.026), (I-749)+(1.006)+(3.027), (I-749)+(1.006)+(3.028), (I-749)+(1.006)+(3.029), (I-749)+(1.006)+(3.030), (I-749)+(1.006)+(3.031), (I-749)+(1.006)+(5.001), (I-749)+(1.006)+(5.002), (I-749)+(1.006)+(5.003), (I-749)+(1.006)+(5.004), (I-749)+(1.006)+(5.005), (I-749)+(1.006)+(5.006), (I-749)+(1.006)+(5.007), (I-749)+(1.006)+(5.008), (I-749)+(1.006)+(5.009), (I-749)+(1.006)+(5.010), (I-749)+(1.006)+(5.011), (I-749)+(1.006)+(5.012), (I-749)+(1.006)+(5.013), (I-749)+(1.006)+(5.014), (I-749)+(1.006)+(5.015), (I-749)+(1.006)+(5.016), (I-749)+(1.006)+(5.017), (I-749)+(1.006)+(5.018), (I-749)+(1.006)+(5.019), (I-749)+(1.006)+(5.020), (I-749)+(1.006)+(5.021), (I-749)+(1.006)+(5.022), (I-749)+(1.006)+(5.023), (I-749)+(1.006)+(6.001), (I-749)+(1.006)+(6.002), (I-749)+(1.006)+(6.003), (I-749)+(1.006)+(6.004), (I-749)+(1.006)+(7.001), (I-749)+(1.006)+(7.002), (I-749)+(1.006)+(7.003), (I-749)+(1.006)+(7.004), (I-749)+(1.006)+(7.005), (I-749)+(1.006)+(7.006), (I-749)+(1.006)+(9.001), (I-749)+(1.006)+(9.002), (I-749)+(1.006)+(9.003), (I-749)+(1.006)+(9.004), (I-749)+(1.006)+(9.005), (I-749)+(1.006)+(9.006), (I-749)+(1.006)+(9.007), (I-749)+(1.006)+(9.008), (I-749)+(1.006)+(9.009), (I-749)+(1.006)+(14.001), (I-749)+(1.006)+(14.002), (I-749)+(1.006)+(15.008), (I-749)+(1.006)+(15.011), (I-749)+(1.006)+(15.012), (I-749)+(1.006)+(15.016), (I-749)+(1.006)+(15.025), (I-749)+(1.006)+(15.027), (I-749)+(1.006)+(15.047), (I-749)+(1.006)+(15.063), (I-749)+(1.006)+(15.064), (I-749)+(1.006)+(16.001), (I-749)+(1.006)+(16.002), (I-749)+(1.006)+(16.003), (I-749)+(1.006)+(16.004), (I-749)+(1.006)+(16.005), (I-749)+(1.006)+(16.006), (I-749)+(1.006)+(16.007), (I-749)+(1.006)+(16.008), (I-749)+(1.006)+(17.001), (I-749)+(1.006)+(17.002), (I-749)+(1.006)+(17.003), (I-749)+(1.006)+(17.004), (I-749)+(1.006)+(17.005), (I-749)+(1.006)+(17.006), (I-749)+(1.006)+(17.007), (I-749)+(1.006)+(17.008), (I-749)+(1.006)+(17.009), (I-749)+(1.006)+(17.010), (I-749)+(1.006)+(17.011), (I-749)+(1.006)+(17.012), (I-749)+(1.006)+(18.001),

(I-749)+(1.007)+(1.008), (I-749)+(1.007)+(1.009), (I-749)+(1.007)+(1.010), (I-749)+(1.007)+(1.011), (I-749)+(1.007)+(1.012), (I-749)+(1.007)+(1.013), (I-749)+(1.007)+(1.014), (I-749)+(1.007)+(1.015), (I-749)+(1.007)+(1.016), (I-749)+(1.007)+(1.017), (I-749)+(1.007)+(1.018), (I-749)+(1.007)+(1.019), (I-749)+(1.007)+(1.020), (I-749)+(1.007)+(1.021), (I-749)+(1.007)+(1.022), (I-749)+(1.007)+(1.023), (I-749)+(1.007)+(1.024), (I-749)+(1.007)+(1.025), (I-749)+(1.007)+(1.026), (I-749)+(1.007)+(1.027), (I-749)+(1.007)+(1.028), (I-749)+(1.007)+(1.029), (I-749)+(1.007)+(1.030), (I-749)+(1.007)+(1.031), (I-749)+(1.007)+(1.032), (I-749)+(1.007)+(1.033), (I-749)+(1.007)+(1.034), (I-749)+(1.007)+(1.035), (I-749)+(1.007)+(1.036), (I-749)+(1.007)+(1.037), (I-749)+(1.007)+(1.038), (I-749)+(1.007)+(1.039), (I-749)+(1.007)+(1.040), (I-749)+(1.007)+(1.041), (I-749)+(1.007)+(1.042), (I-749)+(1.007)+(1.043), (I-749)+(1.007)+(1.044), (I-749)+(1.007)+(1.045), (I-749)+(1.007)+(1.046), (I-749)+(1.007)+(1.047), (I-749)+(1.007)+(1.048), (I-749)+(1.007)+(1.049), (I-749)+(1.007)+(1.050), (I-749)+(1.007)+(1.051), (I-749)+(1.007)+(1.052), (I-749)+(1.007)+(1.053), (I-749)+(1.007)+(1.054), (I-749)+(1.007)+(1.055), (I-749)+(1.007)+(1.056), (I-749)+(1.007)+(1.057), (I-749)+(1.007)+(1.058), (I-749)+(1.007)+(1.059), (I-749)+(1.007)+(1.060), (I-749)+(1.007)+(1.061), (I-749)+(1.007)+(1.062), (I-749)+(1.007)+(1.063), (I-749)+(1.007)+(1.064), (I-749)+(1.007)+(1.065), (I-749)+(1.007)+(1.066), (I-749)+(1.007)+(1.067), (I-749)+(1.007)+(1.068), (I-749)+(1.007)+(1.069), (I-749)+(1.007)+(1.070), (I-749)+(1.007)+(1.071), (I-749)+(1.007)+(1.072), (I-749)+(1.007)+(1.073), (I-749)+(1.007)+(1.074), (I-749)+(1.007)+(1.075), (I-749)+(1.007)+(1.076), (I-749)+(1.007)+(1.077), (I-749)+(1.007)+(1.078), (I-749)+(1.007)+(1.079), (I-749)+(1.007)+(1.080), (I-749)+(1.007)+(1.081), (I-749)+(1.007)+(1.082), (I-749)+(1.007)+(1.083), (I-749)+(1.007)+(1.084), (I-749)+(1.007)+(1.085), (I-749)+(1.007)+(1.086), (I-749)+(1.007)+(1.087), (I-749)+(1.007)+(1.088), (I-749)+(1.007)+(1.089), (I-749)+(1.007)+(1.090), (I-749)+(1.007)+(1.091), (I-749)+(1.007)+(1.092), (I-749)+(1.007)+(2.001), (I-749)+(1.007)+(2.002), (I-749)+(1.007)+(2.003), (I-749)+(1.007)+(2.004), (I-749)+(1.007)+(2.005), (I-749)+(1.007)+(2.006), (I-749)+(1.007)+(2.007), (I-749)+(1.007)+(2.008), (I-749)+(1.007)+(2.009), (I-749)+(1.007)+(2.010), (I-749)+(1.007)+(2.011), (I-749)+(1.007)+(2.012), (I-749)+(1.007)+(2.013), (I-749)+(1.007)+(2.014), (I-749)+(1.007)+(2.015), (I-749)+(1.007)+(2.016), (I-749)+(1.007)+(2.017), (I-749)+(1.007)+(2.018), (I-749)+(1.007)+(2.019), (I-749)+(1.007)+(2.020), (I-749)+(1.007)+(2.021), (I-749)+(1.007)+(2.022), (I-749)+(1.007)+(2.023), (I-749)+(1.007)+(2.024), (I-749)+(1.007)+(2.025), (I-749)+(1.007)+(2.026), (I-749)+(1.007)+(2.027), (I-749)+(1.007)+(2.028), (I-749)+(1.007)+(2.029), (I-749)+(1.007)+(2.030), (I-749)+(1.007)+(2.031), (I-749)+(1.007)+(2.032), (I-749)+(1.007)+(2.033), (I-749)+(1.007)+(2.034), (I-749)+(1.007)+(2.035), (I-749)+(1.007)+(2.036), (I-749)+(1.007)+(2.037), (I-749)+(1.007)+(2.038), (I-749)+(1.007)+(2.039), (I-749)+(1.007)+(2.040), (I-749)+(1.007)+(2.041), (I-749)+(1.007)+(2.042), (I-749)+(1.007)+(2.043), (I-749)+(1.007)+(2.044), (I-749)+(1.007)+(2.045), (I-749)+(1.007)+(2.046), (I-749)+(1.007)+(2.047), (I-749)+(1.007)+(2.048), (I-749)+(1.007)+(2.049), (I-749)+(1.007)+(2.050), (I-749)+(1.007)+(2.051), (I-749)+(1.007)+(2.052), (I-749)+(1.007)+(2.053), (I-749)+(1.007)+(2.054), (I-749)+(1.007)+(2.055), (I-749)+(1.007)+(2.056), (I-749)+(1.007)+(2.057), (I-749)+(1.007)+(2.058), (I-749)+(1.007)+(2.059), (I-749)+(1.007)+(3.001), (I-749)+(1.007)+(3.002), (I-749)+(1.007)+(3.003), (I-749)+(1.007)+(3.004), (I-749)+(1.007)+(3.005), (I-749)+(1.007)+(3.006), (I-749)+(1.007)+(3.007), (I-749)+(1.007)+(3.008), (I-749)+(1.007)+(3.009), (I-749)+(1.007)+(3.010), (I-749)+(1.007)+(3.011), (I-749)+(1.007)+(3.012), (I-749)+(1.007)+(3.013), (I-749)+(1.007)+(3.014), (I-749)+(1.007)+(3.015), (I-749)+(1.007)+(3.016), (I-749)+(1.007)+(3.017), (I-749)+(1.007)+(3.018), (I-749)+(1.007)+(3.019), (I-749)+(1.007)+(3.020), (I-749)+(1.007)+(3.021), (I-749)+(1.007)+(3.022), (I-749)+(1.007)+(3.023), (I-749)+(1.007)+(3.024), (I-749)+(1.007)+(3.025), (I-749)+(1.007)+(3.026), (I-749)+(1.007)+(3.027), (I-749)+(1.007)+(3.028), (I-749)+(1.007)+(3.029), (I-749)+(1.007)+(3.030), (I-749)+(1.007)+(3.031), (I-749)+(1.007)+(5.001), (I-749)+(1.007)+(5.002), (I-749)+(1.007)+(5.003), (I-749)+(1.007)+(5.004), (I-749)+(1.007)+(5.005), (I-749)+(1.007)+(5.006), (I-749)+(1.007)+(5.007), (I-749)+(1.007)+(5.008), (I-749)+(1.007)+(5.009), (I-749)+(1.007)+(5.010), (I-749)+(1.007)+(5.011), (I-749)+(1.007)+(5.012), (I-749)+(1.007)+(5.013), (I-749)+(1.007)+(5.014), (I-749)+(1.007)+(5.015), (I-749)+(1.007)+(5.016), (I-749)+(1.007)+(5.017), (I-749)+(1.007)+(5.018), (I-749)+(1.007)+(5.019), (I-749)+(1.007)+(5.020), (I-749)+(1.007)+(5.021), (I-749)+(1.007)+(5.022), (I-749)+(1.007)+(5.023), (I-749)+(1.007)+(6.001), (I-749)+(1.007)+(6.002), (I-749)+(1.007)+(6.003), (I-749)+(1.007)+(6.004), (I-749)+(1.007)+(7.001), (I-749)+(1.007)+(7.002), (I-749)+(1.007)+(7.003), (I-749)+(1.007)+(7.004), (I-749)+(1.007)+(7.005), (I-749)+(1.007)+(7.006), (I-749)+(1.007)+(9.001), (I-749)+(1.007)+(9.002), (I-749)+(1.007)+(9.003), (I-749)+(1.007)+(9.004), (I-749)+(1.007)+(9.005), (I-749)+(1.007)+(9.006), (I-749)+(1.007)+(9.007), (I-749)+(1.007)+(9.008), (I-749)+(1.007)+(9.009), (I-749)+(1.007)+(14.001), (I-749)+(1.007)+(14.002), (I-749)+(1.007)+(15.008), (I-749)+(1.007)+(15.011), (I-749)+(1.007)+(15.012), (I-749)+(1.007)+(15.016), (I-749)+(1.007)+(15.025), (I-749)+(1.007)+(15.027), (I-749)+(1.007)+(15.047), (I-749)+(1.007)+(15.063), (I-749)+(1.007)+(15.064), (I-749)+(1.007)+(16.001), (I-749)+(1.007)+(16.002), (I-749)+(1.007)+(16.003), (I-749)+(1.007)+(16.004), (I-749)+(1.007)+(16.005), (I-749)+(1.007)+(16.006), (I-749)+(1.007)+(16.007), (I-749)+(1.007)+(16.008), (I-749)+(1.007)+(17.001), (I-749)+(1.007)+(17.002), (I-749)+(1.007)+(17.003), (I-749)+(1.007)+(17.004), (I-749)+(1.007)+(17.005), (I-749)+(1.007)+(17.006), (I-749)+(1.007)+(17.007), (I-749)+(1.007)+(17.008), (I-749)+(1.007)+(17.009), (I-749)+(1.007)+(17.010), (I-749)+(1.007)+(17.011), (I-749)+(1.007)+(17.012), (I-749)+(1.007)+(18.001),

(I-749)+(1.008)+(1.009), (I-749)+(1.008)+(1.010), (I-749)+(1.008)+(1.011), (I-749)+(1.008)+(1.012), (I-749)+(1.008)+(1.013), (I-749)+(1.008)+(1.014), (I-749)+(1.008)+(1.015), (I-749)+(1.008)+(1.016), (I-749)+(1.008)+(1.017), (I-749)+(1.008)+(1.018), (I-749)+(1.008)+(1.019), (I-749)+(1.008)+(1.020), (I-749)+(1.008)+(1.021), (I-749)+(1.008)+(1.022), (I-749)+(1.008)+(1.023), (I-749)+(1.008)+(1.024), (I-749)+(1.008)+(1.025), (I-749)+(1.008)+(1.026), (I-749)+(1.008)+(1.027), (I-749)+(1.008)+(1.028), (I-749)+(1.008)+(1.029), (I-749)+(1.008)+(1.030), (I-749)+(1.008)+(1.031), (I-749)+(1.008)+(1.032), (I-749)+(1.008)+(1.033), (I-749)+(1.008)+(1.034), (I-749)+(1.008)+(1.035), (I-749)+(1.008)+(1.036), (I-749)+(1.008)+(1.037), (I-749)+(1.008)+(1.038), (I-749)+(1.008)+(1.039), (I-749)+(1.008)+(1.040), (I-749)+(1.008)+(1.041), (I-749)+(1.008)+(1.042), (I-749)+(1.008)+(1.043), (I-749)+(1.008)+(1.044), (I-749)+(1.008)+(1.045), (I-749)+(1.008)+(1.046), (I-749)+(1.008)+(1.047), (I-749)+(1.008)+(1.048), (I-749)+(1.008)+(1.049), (I-749)+(1.008)+(1.050), (I-749)+(1.008)+(1.051), (I-749)+(1.008)+(1.052), (I-749)+(1.008)+(1.053), (I-749)+(1.008)+(1.054), (I-749)+(1.008)+(1.055), (I-749)+(1.008)+(1.056), (I-749)+(1.008)+(1.057), (I-749)+(1.008)+(1.058), (I-749)+(1.008)+(1.059), (I-749)+(1.008)+(1.060), (I-749)+(1.008)+(1.061), (I-749)+(1.008)+(1.062), (I-749)+(1.008)+(1.063), (I-749)+(1.008)+(1.064), (I-749)+(1.008)+(1.065), (I-749)+(1.008)+(1.066), (I-749)+(1.008)+(1.067), (I-749)+(1.008)+(1.068), (I-749)+(1.008)+(1.069), (I-749)+(1.008)+(1.070), (I-749)+(1.008)+(1.071), (I-749)+(1.008)+(1.072), (I-749)+(1.008)+(1.073), (I-749)+(1.008)+(1.074), (I-749)+(1.008)+(1.075), (I-749)+(1.008)+(1.076), (I-749)+(1.008)+(1.077), (I-749)+(1.008)+(1.078), (I-749)+(1.008)+(1.079), (I-749)+(1.008)+(1.080), (I-749)+(1.008)+(1.081), (I-749)+(1.008)+(1.082), (I-749)+(1.008)+(1.083), (I-749)+(1.008)+(1.084), (I-749)+(1.008)+(1.085), (I-749)+(1.008)+(1.086), (I-749)+(1.008)+(1.087), (I-749)+(1.008)+(1.088), (I-749)+(1.008)+(1.089), (I-749)+(1.008)+(1.090), (I-749)+(1.008)+(1.091), (I-749)+(1.008)+(1.092), (I-749)+(1.008)+(2.001), (I-749)+(1.008)+(2.002), (I-749)+(1.008)+(2.003), (I-749)+(1.008)+(2.004), (I-749)+(1.008)+(2.005), (I-749)+(1.008)+(2.006), (I-749)+(1.008)+(2.007), (I-749)+(1.008)+(2.008), (I-749)+(1.008)+(2.009), (I-749)+(1.008)+(2.010), (I-749)+(1.008)+(2.011), (I-749)+(1.008)+(2.012), (I-749)+(1.008)+(2.013), (I-749)+(1.008)+(2.014), (I-749)+(1.008)+(2.015), (I-749)+(1.008)+(2.016), (I-749)+(1.008)+(2.017), (I-749)+(1.008)+(2.018), (I-749)+(1.008)+(2.019), (I-749)+(1.008)+(2.020), (I-749)+(1.008)+(2.021), (I-749)+(1.008)+(2.022), (I-749)+(1.008)+(2.023), (I-749)+(1.008)+(2.024), (I-749)+(1.008)+(2.025), (I-749)+(1.008)+(2.026), (I-749)+(1.008)+(2.027), (I-749)+(1.008)+(2.028), (I-749)+(1.008)+(2.029), (I-749)+(1.008)+(2.030), (I-749)+(1.008)+(2.031), (I-749)+(1.008)+(2.032), (I-749)+(1.008)+(2.033), (I-749)+(1.008)+(2.034), (I-749)+(1.008)+(2.035), (I-749)+(1.008)+(2.036), (I-749)+(1.008)+(2.037), (I-749)+(1.008)+(2.038), (I-749)+(1.008)+(2.039), (I-749)+(1.008)+(2.040), (I-749)+(1.008)+(2.041), (I-749)+(1.008)+(2.042), (I-749)+(1.008)+(2.043), (I-749)+(1.008)+(2.044), (I-749)+(1.008)+(2.045), (I-749)+(1.008)+(2.046), (I-749)+(1.008)+(2.047), (I-749)+(1.008)+(2.048), (I-749)+(1.008)+(2.049), (I-749)+(1.008)+(2.050), (I-749)+(1.008)+(2.051), (I-749)+(1.008)+(2.052), (I-749)+(1.008)+(2.053), (I-749)+(1.008)+(2.054), (I-749)+(1.008)+(2.055), (I-749)+(1.008)+(2.056), (I-749)+(1.008)+(2.057), (I-749)+(1.008)+(2.058), (I-749)+(1.008)+(2.059), (I-749)+(1.008)+(3.001), (I-749)+(1.008)+(3.002), (I-749)+(1.008)+(3.003), (I-749)+(1.008)+(3.004), (I-749)+(1.008)+(3.005), (I-749)+(1.008)+(3.006), (I-749)+(1.008)+(3.007), (I-749)+(1.008)+(3.008), (I-749)+(1.008)+(3.009), (I-749)+(1.008)+(3.010), (I-749)+(1.008)+(3.011), (I-749)+(1.008)+(3.012), (I-749)+(1.008)+(3.013), (I-749)+(1.008)+(3.014), (I-749)+(1.008)+(3.015), (I-749)+(1.008)+(3.016), (I-749)+(1.008)+(3.017), (I-749)+(1.008)+(3.018), (I-749)+(1.008)+(3.019), (I-749)+(1.008)+(3.020), (I-749)+(1.008)+(3.021), (I-749)+(1.008)+(3.022), (I-749)+(1.008)+(3.023), (I-749)+(1.008)+(3.024), (I-749)+(1.008)+(3.025), (I-749)+(1.008)+(3.026), (I-749)+(1.008)+(3.027), (I-749)+(1.008)+(3.028), (I-749)+(1.008)+(3.029), (I-749)+(1.008)+(3.030), (I-749)+(1.008)+(3.031), (I-749)+(1.008)+(5.001), (I-749)+(1.008)+(5.002), (I-749)+(1.008)+(5.003), (I-749)+(1.008)+(5.004), (I-749)+(1.008)+(5.005), (I-749)+(1.008)+(5.006), (I-749)+(1.008)+(5.007), (I-749)+(1.008)+(5.008), (I-749)+(1.008)+(5.009), (I-749)+(1.008)+(5.010), (I-749)+(1.008)+(5.011), (I-749)+(1.008)+(5.012), (I-749)+(1.008)+(5.013), (I-749)+(1.008)+(5.014), (I-749)+(1.008)+(5.015), (I-749)+(1.008)+(5.016), (I-749)+(1.008)+(5.017), (I-749)+(1.008)+(5.018), (I-749)+(1.008)+(5.019), (I-749)+(1.008)+(5.020), (I-749)+(1.008)+(5.021), (I-749)+(1.008)+(5.022), (I-749)+(1.008)+(5.023), (I-749)+(1.008)+(6.001), (I-749)+(1.008)+(6.002), (I-749)+(1.008)+(6.003), (I-749)+(1.008)+(6.004), (I-749)+(1.008)+(7.001), (I-749)+(1.008)+(7.002), (I-749)+(1.008)+(7.003), (I-749)+(1.008)+(7.004), (I-749)+(1.008)+(7.005), (I-749)+(1.008)+(7.006), (I-749)+(1.008)+(9.001), (I-749)+(1.008)+(9.002), (I-749)+(1.008)+(9.003), (I-749)+(1.008)+(9.004), (I-749)+(1.008)+(9.005), (I-749)+(1.008)+(9.006), (I-749)+(1.008)+(9.007), (I-749)+(1.008)+(9.008), (I-749)+(1.008)+(9.009), (I-749)+(1.008)+(14.001), (I-749)+(1.008)+(14.002), (I-749)+(1.008)+(15.008), (I-749)+(1.008)+(15.011), (I-749)+(1.008)+(15.012), (I-749)+(1.008)+(15.016), (I-749)+(1.008)+(15.025), (I-749)+(1.008)+(15.027), (I-749)+(1.008)+(15.047), (I-749)+(1.008)+(15.063), (I-749)+(1.008)+(15.064), (I-749)+(1.008)+(16.001), (I-749)+(1.008)+(16.002), (I-749)+(1.008)+(16.003), (I-749)+(1.008)+(16.004), (I-749)+(1.008)+(16.005), (I-749)+(1.008)+(16.006), (I-749)+(1.008)+(16.007), (I-749)+(1.008)+(16.008), (I-749)+(1.008)+(17.001), (I-749)+(1.008)+(17.002), (I-749)+(1.008)+(17.003), (I-749)+(1.008)+(17.004), (I-749)+(1.008)+(17.005), (I-749)+(1.008)+(17.006), (I-749)+(1.008)+(17.007), (I-749)+(1.008)+(17.008), (I-749)+(1.008)+(17.009), (I-749)+(1.008)+(17.010), (I-749)+(1.008)+(17.011), (I-749)+(1.008)+(17.012), (I-749)+(1.008)+(18.001),

(I-749)+(1.009)+(1.010), (I-749)+(1.009)+(1.011), (I-749)+(1.009)+(1.012), (I-749)+(1.009)+(1.013), (I-749)+(1.009)+(1.014), (I-749)+(1.009)+(1.015), (I-749)+(1.009)+(1.016), (I-749)+(1.009)+(1.017), (I-749)+(1.009)+(1.018), (I-749)+(1.009)+(1.019), (I-749)+(1.009)+(1.020), (I-749)+(1.009)+(1.021), (I-749)+(1.009)+(1.022), (I-749)+(1.009)+(1.023), (I-749)+(1.009)+(1.024), (I-749)+(1.009)+(1.025), (I-749)+(1.009)+(1.026), (I-749)+(1.009)+(1.027), (I-749)+(1.009)+(1.028), (I-749)+(1.009)+(1.029), (I-749)+(1.009)+(1.030), (I-749)+(1.009)+(1.031), (I-749)+(1.009)+(1.032), (I-749)+(1.009)+(1.033), (I-749)+(1.009)+(1.034), (I-749)+(1.009)+(1.035), (I-749)+(1.009)+(1.036), (I-749)+(1.009)+(1.037), (I-749)+(1.009)+(1.038), (I-749)+(1.009)+(1.039), (I-749)+(1.009)+(1.040), (I-749)+(1.009)+(1.041), (I-749)+(1.009)+(1.042), (I-749)+(1.009)+(1.043), (I-749)+(1.009)+(1.044), (I-749)+(1.009)+(1.045), (I-749)+(1.009)+(1.046), (I-749)+(1.009)+(1.047), (I-749)+(1.009)+(1.048), (I-749)+(1.009)+(1.049), (I-749)+(1.009)+(1.050), (I-749)+(1.009)+(1.051), (I-749)+(1.009)+(1.052), (I-749)+(1.009)+(1.053), (I-749)+(1.009)+(1.054), (I-749)+(1.009)+(1.055), (I-749)+(1.009)+(1.056), (I-749)+(1.009)+(1.057), (I-749)+(1.009)+(1.058), (I-749)+(1.009)+(1.059), (I-749)+(1.009)+(1.060), (I-749)+(1.009)+(1.061), (I-749)+(1.009)+(1.062), (I-749)+(1.009)+(1.063), (I-749)+(1.009)+(1.064), (I-749)+(1.009)+(1.065), (I-749)+(1.009)+(1.066), (I-749)+(1.009)+(1.067), (I-749)+(1.009)+(1.068), (I-749)+(1.009)+(1.069), (I-749)+(1.009)+(1.070), (I-749)+(1.009)+(1.071), (I-749)+(1.009)+(1.072), (I-749)+(1.009)+(1.073), (I-749)+(1.009)+(1.074), (I-749)+(1.009)+(1.075), (I-749)+(1.009)+(1.076), (I-749)+(1.009)+(1.077), (I-749)+(1.009)+(1.078), (I-749)+(1.009)+(1.079), (I-749)+(1.009)+(1.080), (I-749)+(1.009)+(1.081), (I-749)+(1.009)+(1.082), (I-749)+(1.009)+(1.083), (I-749)+(1.009)+(1.084), (I-749)+(1.009)+(1.085), (I-749)+(1.009)+(1.086), (I-749)+(1.009)+(1.087), (I-749)+(1.009)+(1.088), (I-749)+(1.009)+(1.089), (I-749)+(1.009)+(1.090), (I-749)+(1.009)+(1.091), (I-749)+(1.009)+(1.092), (I-749)+(1.009)+(2.001), (I-749)+(1.009)+(2.002), (I-749)+(1.009)+(2.003), (I-749)+(1.009)+(2.004), (I-749)+(1.009)+(2.005), (I-749)+(1.009)+(2.006), (I-749)+(1.009)+(2.007), (I-749)+(1.009)+(2.008), (I-749)+(1.009)+(2.009), (I-749)+(1.009)+(2.010), (I-749)+(1.009)+(2.011), (I-749)+(1.009)+(2.012), (I-749)+(1.009)+(2.013), (I-749)+(1.009)+(2.014), (I-749)+(1.009)+(2.015), (I-749)+(1.009)+(2.016), (I-749)+(1.009)+(2.017), (I-749)+(1.009)+(2.018), (I-749)+(1.009)+(2.019), (I-749)+(1.009)+(2.020), (I-749)+(1.009)+(2.021), (I-749)+(1.009)+(2.022), (I-749)+(1.009)+(2.023), (I-749)+(1.009)+(2.024), (I-749)+(1.009)+(2.025), (I-749)+(1.009)+(2.026), (I-749)+(1.009)+(2.027), (I-749)+(1.009)+(2.028), (I-749)+(1.009)+(2.029), (I-749)+(1.009)+(2.030), (I-749)+(1.009)+(2.031), (I-749)+(1.009)+(2.032), (I-749)+(1.009)+(2.033), (I-749)+(1.009)+(2.034), (I-749)+(1.009)+(2.035), (I-749)+(1.009)+(2.036), (I-749)+(1.009)+(2.037), (I-749)+(1.009)+(2.038), (I-749)+(1.009)+(2.039), (I-749)+(1.009)+(2.040), (I-749)+(1.009)+(2.041), (I-749)+(1.009)+(2.042), (I-749)+(1.009)+(2.043), (I-749)+(1.009)+(2.044), (I-749)+(1.009)+(2.045), (I-749)+(1.009)+(2.046), (I-749)+(1.009)+(2.047), (I-749)+(1.009)+(2.048), (I-749)+(1.009)+(2.049), (I-749)+(1.009)+(2.050), (I-749)+(1.009)+(2.051), (I-749)+(1.009)+(2.052), (I-749)+(1.009)+(2.053), (I-749)+(1.009)+(2.054), (I-749)+(1.009)+(2.055), (I-749)+(1.009)+(2.056), (I-749)+(1.009)+(2.057), (I-749)+(1.009)+(2.058), (I-749)+(1.009)+(2.059), (I-749)+(1.009)+(3.001), (I-749)+(1.009)+(3.002), (I-749)+(1.009)+(3.003), (I-749)+(1.009)+(3.004), (I-749)+(1.009)+(3.005), (I-749)+(1.009)+(3.006), (I-749)+(1.009)+(3.007), (I-749)+(1.009)+(3.008), (I-749)+(1.009)+(3.009), (I-749)+(1.009)+(3.010), (I-749)+(1.009)+(3.011), (I-749)+(1.009)+(3.012), (I-749)+(1.009)+(3.013), (I-749)+(1.009)+(3.014), (I-749)+(1.009)+(3.015), (I-749)+(1.009)+(3.016), (I-749)+(1.009)+(3.017), (I-749)+(1.009)+(3.018), (I-749)+(1.009)+(3.019), (I-749)+(1.009)+(3.020), (I-749)+(1.009)+(3.021), (I-749)+(1.009)+(3.022), (I-749)+(1.009)+(3.023), (I-749)+(1.009)+(3.024), (I-749)+(1.009)+(3.025), (I-749)+(1.009)+(3.026), (I-749)+(1.009)+(3.027), (I-749)+(1.009)+(3.028), (I-749)+(1.009)+(3.029), (I-749)+(1.009)+(3.030), (I-749)+(1.009)+(3.031), (I-749)+(1.009)+(5.001), (I-749)+(1.009)+(5.002), (I-749)+(1.009)+(5.003), (I-749)+(1.009)+(5.004), (I-749)+(1.009)+(5.005), (I-749)+(1.009)+(5.006), (I-749)+(1.009)+(5.007), (I-749)+(1.009)+(5.008), (I-749)+(1.009)+(5.009), (I-749)+(1.009)+(5.010), (I-749)+(1.009)+(5.011), (I-749)+(1.009)+(5.012), (I-749)+(1.009)+(5.013), (I-749)+(1.009)+(5.014), (I-749)+(1.009)+(5.015), (I-749)+(1.009)+(5.016), (I-749)+(1.009)+(5.017), (I-749)+(1.009)+(5.018), (I-749)+(1.009)+(5.019), (I-749)+(1.009)+(5.020), (I-749)+(1.009)+(5.021), (I-749)+(1.009)+(5.022), (I-749)+(1.009)+(5.023), (I-749)+(1.009)+(6.001), (I-749)+(1.009)+(6.002), (I-749)+(1.009)+(6.003), (I-749)+(1.009)+(6.004), (I-749)+(1.009)+(7.001), (I-749)+(1.009)+(7.002), (I-749)+(1.009)+(7.003), (I-749)+(1.009)+(7.004), (I-749)+(1.009)+(7.005), (I-749)+(1.009)+(7.006), (I-749)+(1.009)+(9.001), (I-749)+(1.009)+(9.002), (I-749)+(1.009)+(9.003), (I-749)+(1.009)+(9.004), (I-749)+(1.009)+(9.005), (I-749)+(1.009)+(9.006), (I-749)+(1.009)+(9.007), (I-749)+(1.009)+(9.008), (I-749)+(1.009)+(9.009), (I-749)+(1.009)+(14.001), (I-749)+(1.009)+(14.002), (I-749)+(1.009)+(15.008), (I-749)+(1.009)+(15.011), (I-749)+(1.009)+(15.012), (I-749)+(1.009)+(15.016), (I-749)+(1.009)+(15.025), (I-749)+(1.009)+(15.027), (I-749)+(1.009)+(15.047), (I-749)+(1.009)+(15.063), (I-749)+(1.009)+(15.064), (I-749)+(1.009)+(16.001), (I-749)+(1.009)+(16.002), (I-749)+(1.009)+(16.003), (I-749)+(1.009)+(16.004), (I-749)+(1.009)+(16.005), (I-749)+(1.009)+(16.006), (I-749)+(1.009)+(16.007), (I-749)+(1.009)+(16.008), (I-749)+(1.009)+(17.001), (I-749)+(1.009)+(17.002), (I-749)+(1.009)+(17.003), (I-749)+(1.009)+(17.004), (I-749)+(1.009)+(17.005), (I-749)+(1.009)+(17.006), (I-749)+(1.009)+(17.007), (I-749)+(1.009)+(17.008), (I-749)+(1.009)+(17.009), (I-749)+(1.009)+(17.010), (I-749)+(1.009)+(17.011), (I-749)+(1.009)+(17.012), (I-749)+(1.009)+(18.001),

(I-749)+(1.010)+(1.011), (I-749)+(1.010)+(1.012), (I-749)+(1.010)+(1.013), (I-749)+(1.010)+(1.014), (I-749)+(1.010)+(1.015), (I-749)+(1.010)+(1.016), (I-749)+(1.010)+(1.017), (I-749)+(1.010)+(1.018), (I-749)+(1.010)+(1.019), (I-749)+(1.010)+(1.020), (I-749)+(1.010)+(1.021), (I-749)+(1.010)+(1.022), (I-749)+(1.010)+(1.023), (I-749)+(1.010)+(1.024), (I-749)+(1.010)+(1.025), (I-749)+(1.010)+(1.026), (I-749)+(1.010)+(1.027), (I-749)+(1.010)+(1.028), (I-749)+(1.010)+(1.029), (I-749)+(1.010)+(1.030), (I-749)+(1.010)+(1.031), (I-749)+(1.010)+(1.032), (I-749)+(1.010)+(1.033), (I-749)+(1.010)+(1.034), (I-749)+(1.010)+(1.035), (I-749)+(1.010)+(1.036), (I-749)+(1.010)+(1.037), (I-749)+(1.010)+(1.038), (I-749)+(1.010)+(1.039), (I-749)+(1.010)+(1.040), (I-749)+(1.010)+(1.041), (I-749)+(1.010)+(1.042), (I-749)+(1.010)+(1.043), (I-749)+(1.010)+(1.044), (I-749)+(1.010)+(1.045), (I-749)+(1.010)+(1.046), (I-749)+(1.010)+(1.047), (I-749)+(1.010)+(1.048), (I-749)+(1.010)+(1.049), (I-749)+(1.010)+(1.050), (I-749)+(1.010)+(1.051), (I-749)+(1.010)+(1.052), (I-749)+(1.010)+(1.053), (I-749)+(1.010)+(1.054), (I-749)+(1.010)+(1.055), (I-749)+(1.010)+(1.056), (I-749)+(1.010)+(1.057), (I-749)+(1.010)+(1.058), (I-749)+(1.010)+(1.059), (I-749)+(1.010)+(1.060), (I-749)+(1.010)+(1.061), (I-749)+(1.010)+(1.062), (I-749)+(1.010)+(1.063), (I-749)+(1.010)+(1.064), (I-749)+(1.010)+(1.065), (I-749)+(1.010)+(1.066), (I-749)+(1.010)+(1.067), (I-749)+(1.010)+(1.068), (I-749)+(1.010)+(1.069), (I-749)+(1.010)+(1.070), (I-749)+(1.010)+(1.071), (I-749)+(1.010)+(1.072), (I-749)+(1.010)+(1.073), (I-749)+(1.010)+(1.074), (I-749)+(1.010)+(1.075), (I-749)+(1.010)+(1.076), (I-749)+(1.010)+(1.077), (I-749)+(1.010)+(1.078), (I-749)+(1.010)+(1.079), (I-749)+(1.010)+(1.080), (I-749)+(1.010)+(1.081), (I-749)+(1.010)+(1.082), (I-749)+(1.010)+(1.083), (I-749)+(1.010)+(1.084), (I-749)+(1.010)+(1.085), (I-749)+(1.010)+(1.086), (I-749)+(1.010)+(1.087), (I-749)+(1.010)+(1.088), (I-749)+(1.010)+(1.089), (I-749)+(1.010)+(1.090), (I-749)+(1.010)+(1.091), (I-749)+(1.010)+(1.092), (I-749)+(1.010)+(2.001), (I-749)+(1.010)+(2.002), (I-749)+(1.010)+(2.003), (I-749)+(1.010)+(2.004), (I-749)+(1.010)+(2.005), (I-749)+(1.010)+(2.006), (I-749)+(1.010)+(2.007), (I-749)+(1.010)+(2.008), (I-749)+(1.010)+(2.009), (I-749)+(1.010)+(2.010), (I-749)+(1.010)+(2.011), (I-749)+(1.010)+(2.012), (I-749)+(1.010)+(2.013), (I-749)+(1.010)+(2.014), (I-749)+(1.010)+(2.015), (I-749)+(1.010)+(2.016), (I-749)+(1.010)+(2.017), (I-749)+(1.010)+(2.018), (I-749)+(1.010)+(2.019), (I-749)+(1.010)+(2.020), (I-749)+(1.010)+(2.021), (I-749)+(1.010)+(2.022), (I-749)+(1.010)+(2.023), (I-749)+(1.010)+(2.024), (I-749)+(1.010)+(2.025), (I-749)+(1.010)+(2.026), (I-749)+(1.010)+(2.027), (I-749)+(1.010)+(2.028), (I-749)+(1.010)+(2.029), (I-749)+(1.010)+(2.030), (I-749)+(1.010)+(2.031), (I-749)+(1.010)+(2.032), (I-749)+(1.010)+(2.033), (I-749)+(1.010)+(2.034), (I-749)+(1.010)+(2.035), (I-749)+(1.010)+(2.036), (I-749)+(1.010)+(2.037), (I-749)+(1.010)+(2.038), (I-749)+(1.010)+(2.039), (I-749)+(1.010)+(2.040), (I-749)+(1.010)+(2.041), (I-749)+(1.010)+(2.042), (I-749)+(1.010)+(2.043), (I-749)+(1.010)+(2.044), (I-749)+(1.010)+(2.045), (I-749)+(1.010)+(2.046), (I-749)+(1.010)+(2.047), (I-749)+(1.010)+(2.048), (I-749)+(1.010)+(2.049), (I-749)+(1.010)+(2.050), (I-749)+(1.010)+(2.051), (I-749)+(1.010)+(2.052), (I-749)+(1.010)+(2.053), (I-749)+(1.010)+(2.054), (I-749)+(1.010)+(2.055), (I-749)+(1.010)+(2.056), (I-749)+(1.010)+(2.057), (I-749)+(1.010)+(2.058), (I-749)+(1.010)+(2.059), (I-749)+(1.010)+(3.001), (I-749)+(1.010)+(3.002), (I-749)+(1.010)+(3.003), (I-749)+(1.010)+(3.004), (I-749)+(1.010)+(3.005), (I-749)+(1.010)+(3.006), (I-749)+(1.010)+(3.007), (I-749)+(1.010)+(3.008), (I-749)+(1.010)+(3.009), (I-749)+(1.010)+(3.010), (I-749)+(1.010)+(3.011), (I-749)+(1.010)+(3.012), (I-749)+(1.010)+(3.013), (I-749)+(1.010)+(3.014), (I-749)+(1.010)+(3.015), (I-749)+(1.010)+(3.016), (I-749)+(1.010)+(3.017), (I-749)+(1.010)+(3.018), (I-749)+(1.010)+(3.019), (I-749)+(1.010)+(3.020), (I-749)+(1.010)+(3.021), (I-749)+(1.010)+(3.022), (I-749)+(1.010)+(3.023), (I-749)+(1.010)+(3.024), (I-749)+(1.010)+(3.025), (I-749)+(1.010)+(3.026), (I-749)+(1.010)+(3.027), (I-749)+(1.010)+(3.028), (I-749)+(1.010)+(3.029), (I-749)+(1.010)+(3.030), (I-749)+(1.010)+(3.031), (I-749)+(1.010)+(5.001), (I-749)+(1.010)+(5.002), (I-749)+(1.010)+(5.003), (I-749)+(1.010)+(5.004), (I-749)+(1.010)+(5.005), (I-749)+(1.010)+(5.006), (I-749)+(1.010)+(5.007), (I-749)+(1.010)+(5.008), (I-749)+(1.010)+(5.009), (I-749)+(1.010)+(5.010), (I-749)+(1.010)+(5.011), (I-749)+(1.010)+(5.012), (I-749)+(1.010)+(5.013), (I-749)+(1.010)+(5.014), (I-749)+(1.010)+(5.015), (I-749)+(1.010)+(5.016), (I-749)+(1.010)+(5.017), (I-749)+(1.010)+(5.018), (I-749)+(1.010)+(5.019), (I-749)+(1.010)+(5.020), (I-749)+(1.010)+(5.021), (I-749)+(1.010)+(5.022), (I-749)+(1.010)+(5.023), (I-749)+(1.010)+(6.001), (I-749)+(1.010)+(6.002), (I-749)+(1.010)+(6.003), (I-749)+(1.010)+(6.004), (I-749)+(1.010)+(7.001), (I-749)+(1.010)+(7.002), (I-749)+(1.010)+(7.003), (I-749)+(1.010)+(7.004), (I-749)+(1.010)+(7.005), (I-749)+(1.010)+(7.006), (I-749)+(1.010)+(9.001), (I-749)+(1.010)+(9.002), (I-749)+(1.010)+(9.003), (I-749)+(1.010)+(9.004), (I-749)+(1.010)+(9.005), (I-749)+(1.010)+(9.006), (I-749)+(1.010)+(9.007), (I-749)+(1.010)+(9.008), (I-749)+(1.010)+(9.009), (I-749)+(1.010)+(14.001), (I-749)+(1.010)+(14.002), (I-749)+(1.010)+(15.008), (I-749)+(1.010)+(15.011), (I-749)+(1.010)+(15.012), (I-749)+(1.010)+(15.016), (I-749)+(1.010)+(15.025), (I-749)+(1.010)+(15.027), (I-749)+(1.010)+(15.047), (I-749)+(1.010)+(15.063), (I-749)+(1.010)+(15.064), (I-749)+(1.010)+(16.001), (I-749)+(1.010)+(16.002), (I-749)+(1.010)+(16.003), (I-749)+(1.010)+(16.004), (I-749)+(1.010)+(16.005), (I-749)+(1.010)+(16.006), (I-749)+(1.010)+(16.007), (I-749)+(1.010)+(16.008), (I-749)+(1.010)+(17.001), (I-749)+(1.010)+(17.002), (I-749)+(1.010)+(17.003), (I-749)+(1.010)+(17.004), (I-749)+(1.010)+(17.005), (I-749)+(1.010)+(17.006), (I-749)+(1.010)+(17.007), (I-749)+(1.010)+(17.008), (I-749)+(1.010)+(17.009), (I-749)+(1.010)+(17.010), (I-749)+(1.010)+(17.011), (I-749)+(1.010)+(17.012), (I-749)+(1.010)+(18.001),

(I-749)+(1.011)+(1.012), (I-749)+(1.011)+(1.013), (I-749)+(1.011)+(1.014), (I-749)+(1.011)+(1.015), (I-749)+(1.011)+(1.016), (I-749)+(1.011)+(1.017), (I-749)+(1.011)+(1.018), (I-749)+(1.011)+(1.019), (I-749)+(1.011)+(1.020), (I-749)+(1.011)+(1.021), (I-749)+(1.011)+(1.022), (I-749)+(1.011)+(1.023), (I-749)+(1.011)+(1.024), (I-749)+(1.011)+(1.025), (I-749)+(1.011)+(1.026), (I-749)+(1.011)+(1.027), (I-749)+(1.011)+(1.028), (I-749)+(1.011)+(1.029), (I-749)+(1.011)+(1.030), (I-749)+(1.011)+(1.031), (I-749)+(1.011)+(1.032), (I-749)+(1.011)+(1.033), (I-749)+(1.011)+(1.034), (I-749)+(1.011)+(1.035), (I-749)+(1.011)+(1.036), (I-749)+(1.011)+(1.037), (I-749)+(1.011)+(1.038), (I-749)+(1.011)+(1.039), (I-749)+(1.011)+(1.040), (I-749)+(1.011)+(1.041), (I-749)+(1.011)+(1.042), (I-749)+(1.011)+(1.043), (I-749)+(1.011)+(1.044), (I-749)+(1.011)+(1.045), (I-749)+(1.011)+(1.046), (I-749)+(1.011)+(1.047), (I-749)+(1.011)+(1.048), (I-749)+(1.011)+(1.049), (I-749)+(1.011)+(1.050), (I-749)+(1.011)+(1.051), (I-749)+(1.011)+(1.052), (I-749)+(1.011)+(1.053), (I-749)+(1.011)+(1.054), (I-749)+(1.011)+(1.055), (I-749)+(1.011)+(1.056), (I-749)+(1.011)+(1.057), (I-749)+(1.011)+(1.058), (I-749)+(1.011)+(1.059), (I-749)+(1.011)+(1.060), (I-749)+(1.011)+(1.061), (I-749)+(1.011)+(1.062), (I-749)+(1.011)+(1.063), (I-749)+(1.011)+(1.064), (I-749)+(1.011)+(1.065), (I-749)+(1.011)+(1.066), (I-749)+(1.011)+(1.067), (I-749)+(1.011)+(1.068), (I-749)+(1.011)+(1.069), (I-749)+(1.011)+(1.070), (I-749)+(1.011)+(1.071), (I-749)+(1.011)+(1.072), (I-749)+(1.011)+(1.073), (I-749)+(1.011)+(1.074), (I-749)+(1.011)+(1.075), (I-749)+(1.011)+(1.076), (I-749)+(1.011)+(1.077), (I-749)+(1.011)+(1.078), (I-749)+(1.011)+(1.079), (I-749)+(1.011)+(1.080), (I-749)+(1.011)+(1.081), (I-749)+(1.011)+(1.082), (I-749)+(1.011)+(1.083), (I-749)+(1.011)+(1.084), (I-749)+(1.011)+(1.085), (I-749)+(1.011)+(1.086), (I-749)+(1.011)+(1.087), (I-749)+(1.011)+(1.088), (I-749)+(1.011)+(1.089), (I-749)+(1.011)+(1.090), (I-749)+(1.011)+(1.091), (I-749)+(1.011)+(1.092), (I-749)+(1.011)+(2.001), (I-749)+(1.011)+(2.002), (I-749)+(1.011)+(2.003), (I-749)+(1.011)+(2.004), (I-749)+(1.011)+(2.005), (I-749)+(1.011)+(2.006), (I-749)+(1.011)+(2.007), (I-749)+(1.011)+(2.008), (I-749)+(1.011)+(2.009), (I-749)+(1.011)+(2.010), (I-749)+(1.011)+(2.011), (I-749)+(1.011)+(2.012), (I-749)+(1.011)+(2.013), (I-749)+(1.011)+(2.014), (I-749)+(1.011)+(2.015), (I-749)+(1.011)+(2.016), (I-749)+(1.011)+(2.017), (I-749)+(1.011)+(2.018), (I-749)+(1.011)+(2.019), (I-749)+(1.011)+(2.020), (I-749)+(1.011)+(2.021), (I-749)+(1.011)+(2.022), (I-749)+(1.011)+(2.023), (I-749)+(1.011)+(2.024), (I-749)+(1.011)+(2.025), (I-749)+(1.011)+(2.026), (I-749)+(1.011)+(2.027), (I-749)+(1.011)+(2.028), (I-749)+(1.011)+(2.029), (I-749)+(1.011)+(2.030), (I-749)+(1.011)+(2.031), (I-749)+(1.011)+(2.032), (I-749)+(1.011)+(2.033), (I-749)+(1.011)+(2.034), (I-749)+(1.011)+(2.035), (I-749)+(1.011)+(2.036), (I-749)+(1.011)+(2.037), (I-749)+(1.011)+(2.038), (I-749)+(1.011)+(2.039), (I-749)+(1.011)+(2.040), (I-749)+(1.011)+(2.041), (I-749)+(1.011)+(2.042), (I-749)+(1.011)+(2.043), (I-749)+(1.011)+(2.044), (I-749)+(1.011)+(2.045), (I-749)+(1.011)+(2.046), (I-749)+(1.011)+(2.047), (I-749)+(1.011)+(2.048), (I-749)+(1.011)+(2.049), (I-749)+(1.011)+(2.050), (I-749)+(1.011)+(2.051), (I-749)+(1.011)+(2.052), (I-749)+(1.011)+(2.053), (I-749)+(1.011)+(2.054), (I-749)+(1.011)+(2.055), (I-749)+(1.011)+(2.056), (I-749)+(1.011)+(2.057), (I-749)+(1.011)+(2.058), (I-749)+(1.011)+(2.059), (I-749)+(1.011)+(3.001), (I-749)+(1.011)+(3.002), (I-749)+(1.011)+(3.003), (I-749)+(1.011)+(3.004), (I-749)+(1.011)+(3.005), (I-749)+(1.011)+(3.006), (I-749)+(1.011)+(3.007), (I-749)+(1.011)+(3.008), (I-749)+(1.011)+(3.009), (I-749)+(1.011)+(3.010), (I-749)+(1.011)+(3.011), (I-749)+(1.011)+(3.012), (I-749)+(1.011)+(3.013), (I-749)+(1.011)+(3.014), (I-749)+(1.011)+(3.015), (I-749)+(1.011)+(3.016), (I-749)+(1.011)+(3.017), (I-749)+(1.011)+(3.018), (I-749)+(1.011)+(3.019), (I-749)+(1.011)+(3.020), (I-749)+(1.011)+(3.021), (I-749)+(1.011)+(3.022), (I-749)+(1.011)+(3.023), (I-749)+(1.011)+(3.024), (I-749)+(1.011)+(3.025), (I-749)+(1.011)+(3.026), (I-749)+(1.011)+(3.027), (I-749)+(1.011)+(3.028), (I-749)+(1.011)+(3.029), (I-749)+(1.011)+(3.030), (I-749)+(1.011)+(3.031), (I-749)+(1.011)+(5.001), (I-749)+(1.011)+(5.002), (I-749)+(1.011)+(5.003), (I-749)+(1.011)+(5.004), (I-749)+(1.011)+(5.005), (I-749)+(1.011)+(5.006), (I-749)+(1.011)+(5.007), (I-749)+(1.011)+(5.008), (I-749)+(1.011)+(5.009), (I-749)+(1.011)+(5.010), (I-749)+(1.011)+(5.011), (I-749)+(1.011)+(5.012), (I-749)+(1.011)+(5.013), (I-749)+(1.011)+(5.014), (I-749)+(1.011)+(5.015), (I-749)+(1.011)+(5.016), (I-749)+(1.011)+(5.017), (I-749)+(1.011)+(5.018), (I-749)+(1.011)+(5.019), (I-749)+(1.011)+(5.020), (I-749)+(1.011)+(5.021), (I-749)+(1.011)+(5.022), (I-749)+(1.011)+(5.023), (I-749)+(1.011)+(6.001), (I-749)+(1.011)+(6.002), (I-749)+(1.011)+(6.003), (I-749)+(1.011)+(6.004), (I-749)+(1.011)+(7.001), (I-749)+(1.011)+(7.002), (I-749)+(1.011)+(7.003), (I-749)+(1.011)+(7.004), (I-749)+(1.011)+(7.005), (I-749)+(1.011)+(7.006), (I-749)+(1.011)+(9.001), (I-749)+(1.011)+(9.002), (I-749)+(1.011)+(9.003), (I-749)+(1.011)+(9.004), (I-749)+(1.011)+(9.005), (I-749)+(1.011)+(9.006), (I-749)+(1.011)+(9.007), (I-749)+(1.011)+(9.008), (I-749)+(1.011)+(9.009), (I-749)+(1.011)+(14.001), (I-749)+(1.011)+(14.002), (I-749)+(1.011)+(15.008), (I-749)+(1.011)+(15.011), (I-749)+(1.011)+(15.012), (I-749)+(1.011)+(15.016), (I-749)+(1.011)+(15.025), (I-749)+(1.011)+(15.027), (I-749)+(1.011)+(15.047), (I-749)+(1.011)+(15.063), (I-749)+(1.011)+(15.064), (I-749)+(1.011)+(16.001), (I-749)+(1.011)+(16.002), (I-749)+(1.011)+(16.003), (I-749)+(1.011)+(16.004), (I-749)+(1.011)+(16.005), (I-749)+(1.011)+(16.006), (I-749)+(1.011)+(16.007), (I-749)+(1.011)+(16.008), (I-749)+(1.011)+(17.001), (I-749)+(1.011)+(17.002), (I-749)+(1.011)+(17.003), (I-749)+(1.011)+(17.004), (I-749)+(1.011)+(17.005), (I-749)+(1.011)+(17.006), (I-749)+(1.011)+(17.007), (I-749)+(1.011)+(17.008), (I-749)+(1.011)+(17.009), (I-749)+(1.011)+(17.010), (I-749)+(1.011)+(17.011), (I-749)+(1.011)+(17.012), (I-749)+(1.011)+(18.001),

(I-749)+(1.012)+(1.013), (I-749)+(1.012)+(1.014), (I-749)+(1.012)+(1.015), (I-749)+(1.012)+(1.016), (I-749)+(1.012)+(1.017), (I-749)+(1.012)+(1.018), (I-749)+(1.012)+(1.019), (I-749)+(1.012)+(1.020), (I-749)+(1.012)+(1.021), (I-749)+(1.012)+(1.022), (I-749)+(1.012)+(1.023), (I-749)+(1.012)+(1.024), (I-749)+(1.012)+(1.025), (I-749)+(1.012)+(1.026), (I-749)+(1.012)+(1.027), (I-749)+(1.012)+(1.028), (I-749)+(1.012)+(1.029), (I-749)+(1.012)+(1.030), (I-749)+(1.012)+(1.031), (I-749)+(1.012)+(1.032), (I-749)+(1.012)+(1.033), (I-749)+(1.012)+(1.034), (I-749)+(1.012)+(1.035), (I-749)+(1.012)+(1.036), (I-749)+(1.012)+(1.037), (I-749)+(1.012)+(1.038), (I-749)+(1.012)+(1.039), (I-749)+(1.012)+(1.040), (I-749)+(1.012)+(1.041), (I-749)+(1.012)+(1.042), (I-749)+(1.012)+(1.043), (I-749)+(1.012)+(1.044), (I-749)+(1.012)+(1.045), (I-749)+(1.012)+(1.046), (I-749)+(1.012)+(1.047), (I-749)+(1.012)+(1.048), (I-749)+(1.012)+(1.049), (I-749)+(1.012)+(1.050), (I-749)+(1.012)+(1.051), (I-749)+(1.012)+(1.052), (I-749)+(1.012)+(1.053), (I-749)+(1.012)+(1.054), (I-749)+(1.012)+(1.055), (I-749)+(1.012)+(1.056), (I-749)+(1.012)+(1.057), (I-749)+(1.012)+(1.058), (I-749)+(1.012)+(1.059), (I-749)+(1.012)+(1.060), (I-749)+(1.012)+(1.061), (I-749)+(1.012)+(1.062), (I-749)+(1.012)+(1.063), (I-749)+(1.012)+(1.064), (I-749)+(1.012)+(1.065), (I-749)+(1.012)+(1.066), (I-749)+(1.012)+(1.067), (I-749)+(1.012)+(1.068), (I-749)+(1.012)+(1.069), (I-749)+(1.012)+(1.070), (I-749)+(1.012)+(1.071), (I-749)+(1.012)+(1.072), (I-749)+(1.012)+(1.073), (I-749)+(1.012)+(1.074), (I-749)+(1.012)+(1.075), (I-749)+(1.012)+(1.076), (I-749)+(1.012)+(1.077), (I-749)+(1.012)+(1.078), (I-749)+(1.012)+(1.079), (I-749)+(1.012)+(1.080), (I-749)+(1.012)+(1.081), (I-749)+(1.012)+(1.082), (I-749)+(1.012)+(1.083), (I-749)+(1.012)+(1.084), (I-749)+(1.012)+(1.085), (I-749)+(1.012)+(1.086), (I-749)+(1.012)+(1.087), (I-749)+(1.012)+(1.088), (I-749)+(1.012)+(1.089), (I-749)+(1.012)+(1.090), (I-749)+(1.012)+(1.091), (I-749)+(1.012)+(1.092), (I-749)+(1.012)+(2.001), (I-749)+(1.012)+(2.002), (I-749)+(1.012)+(2.003), (I-749)+(1.012)+(2.004), (I-749)+(1.012)+(2.005), (I-749)+(1.012)+(2.006), (I-749)+(1.012)+(2.007), (I-749)+(1.012)+(2.008), (I-749)+(1.012)+(2.009), (I-749)+(1.012)+(2.010), (I-749)+(1.012)+(2.011), (I-749)+(1.012)+(2.012), (I-749)+(1.012)+(2.013), (I-749)+(1.012)+(2.014), (I-749)+(1.012)+(2.015), (I-749)+(1.012)+(2.016), (I-749)+(1.012)+(2.017), (I-749)+(1.012)+(2.018), (I-749)+(1.012)+(2.019), (I-749)+(1.012)+(2.020), (I-749)+(1.012)+(2.021), (I-749)+(1.012)+(2.022), (I-749)+(1.012)+(2.023), (I-749)+(1.012)+(2.024), (I-749)+(1.012)+(2.025), (I-749)+(1.012)+(2.026), (I-749)+(1.012)+(2.027), (I-749)+(1.012)+(2.028), (I-749)+(1.012)+(2.029), (I-749)+(1.012)+(2.030), (I-749)+(1.012)+(2.031), (I-749)+(1.012)+(2.032), (I-749)+(1.012)+(2.033), (I-749)+(1.012)+(2.034), (I-749)+(1.012)+(2.035), (I-749)+(1.012)+(2.036), (I-749)+(1.012)+(2.037), (I-749)+(1.012)+(2.038), (I-749)+(1.012)+(2.039), (I-749)+(1.012)+(2.040), (I-749)+(1.012)+(2.041), (I-749)+(1.012)+(2.042), (I-749)+(1.012)+(2.043), (I-749)+(1.012)+(2.044), (I-749)+(1.012)+(2.045), (I-749)+(1.012)+(2.046), (I-749)+(1.012)+(2.047), (I-749)+(1.012)+(2.048), (I-749)+(1.012)+(2.049), (I-749)+(1.012)+(2.050), (I-749)+(1.012)+(2.051), (I-749)+(1.012)+(2.052), (I-749)+(1.012)+(2.053), (I-749)+(1.012)+(2.054), (I-749)+(1.012)+(2.055), (I-749)+(1.012)+(2.056), (I-749)+(1.012)+(2.057), (I-749)+(1.012)+(2.058), (I-749)+(1.012)+(2.059), (I-749)+(1.012)+(3.001), (I-749)+(1.012)+(3.002), (I-749)+(1.012)+(3.003), (I-749)+(1.012)+(3.004), (I-749)+(1.012)+(3.005), (I-749)+(1.012)+(3.006), (I-749)+(1.012)+(3.007), (I-749)+(1.012)+(3.008), (I-749)+(1.012)+(3.009), (I-749)+(1.012)+(3.010), (I-749)+(1.012)+(3.011), (I-749)+(1.012)+(3.012), (I-749)+(1.012)+(3.013), (I-749)+(1.012)+(3.014), (I-749)+(1.012)+(3.015), (I-749)+(1.012)+(3.016), (I-749)+(1.012)+(3.017), (I-749)+(1.012)+(3.018), (I-749)+(1.012)+(3.019), (I-749)+(1.012)+(3.020), (I-749)+(1.012)+(3.021), (I-749)+(1.012)+(3.022), (I-749)+(1.012)+(3.023), (I-749)+(1.012)+(3.024), (I-749)+(1.012)+(3.025), (I-749)+(1.012)+(3.026), (I-749)+(1.012)+(3.027), (I-749)+(1.012)+(3.028), (I-749)+(1.012)+(3.029), (I-749)+(1.012)+(3.030), (I-749)+(1.012)+(3.031), (I-749)+(1.012)+(5.001), (I-749)+(1.012)+(5.002), (I-749)+(1.012)+(5.003), (I-749)+(1.012)+(5.004), (I-749)+(1.012)+(5.005), (I-749)+(1.012)+(5.006), (I-749)+(1.012)+(5.007), (I-749)+(1.012)+(5.008), (I-749)+(1.012)+(5.009), (I-749)+(1.012)+(5.010), (I-749)+(1.012)+(5.011), (I-749)+(1.012)+(5.012), (I-749)+(1.012)+(5.013), (I-749)+(1.012)+(5.014), (I-749)+(1.012)+(5.015), (I-749)+(1.012)+(5.016), (I-749)+(1.012)+(5.017), (I-749)+(1.012)+(5.018), (I-749)+(1.012)+(5.019), (I-749)+(1.012)+(5.020), (I-749)+(1.012)+(5.021), (I-749)+(1.012)+(5.022), (I-749)+(1.012)+(5.023), (I-749)+(1.012)+(6.001), (I-749)+(1.012)+(6.002), (I-749)+(1.012)+(6.003), (I-749)+(1.012)+(6.004), (I-749)+(1.012)+(7.001), (I-749)+(1.012)+(7.002), (I-749)+(1.012)+(7.003), (I-749)+(1.012)+(7.004), (I-749)+(1.012)+(7.005), (I-749)+(1.012)+(7.006), (I-749)+(1.012)+(9.001), (I-749)+(1.012)+(9.002), (I-749)+(1.012)+(9.003), (I-749)+(1.012)+(9.004), (I-749)+(1.012)+(9.005), (I-749)+(1.012)+(9.006), (I-749)+(1.012)+(9.007), (I-749)+(1.012)+(9.008), (I-749)+(1.012)+(9.009), (I-749)+(1.012)+(14.001), (I-749)+(1.012)+(14.002), (I-749)+(1.012)+(15.008), (I-749)+(1.012)+(15.011), (I-749)+(1.012)+(15.012), (I-749)+(1.012)+(15.016), (I-749)+(1.012)+(15.025), (I-749)+(1.012)+(15.027), (I-749)+(1.012)+(15.047), (I-749)+(1.012)+(15.063), (I-749)+(1.012)+(15.064), (I-749)+(1.012)+(16.001), (I-749)+(1.012)+(16.002), (I-749)+(1.012)+(16.003), (I-749)+(1.012)+(16.004), (I-749)+(1.012)+(16.005), (I-749)+(1.012)+(16.006), (I-749)+(1.012)+(16.007), (I-749)+(1.012)+(16.008), (I-749)+(1.012)+(17.001), (I-749)+(1.012)+(17.002), (I-749)+(1.012)+(17.003), (I-749)+(1.012)+(17.004), (I-749)+(1.012)+(17.005), (I-749)+(1.012)+(17.006), (I-749)+(1.012)+(17.007), (I-749)+(1.012)+(17.008), (I-749)+(1.012)+(17.009), (I-749)+(1.012)+(17.010), (I-749)+(1.012)+(17.011), (I-749)+(1.012)+(17.012), (I-749)+(1.012)+(18.001),

(I-749)+(1.013)+(1.014), (I-749)+(1.013)+(1.015), (I-749)+(1.013)+(1.016), (I-749)+(1.013)+(1.017), (I-749)+(1.013)+(1.018), (I-749)+(1.013)+(1.019), (I-749)+(1.013)+(1.020), (I-749)+(1.013)+(1.021), (I-749)+(1.013)+(1.022), (I-749)+(1.013)+(1.023), (I-749)+(1.013)+(1.024), (I-749)+(1.013)+(1.025), (I-749)+(1.013)+(1.026), (I-749)+(1.013)+(1.027), (I-749)+(1.013)+(1.028), (I-749)+(1.013)+(1.029), (I-749)+(1.013)+(1.030), (I-749)+(1.013)+(1.031), (I-749)+(1.013)+(1.032), (I-749)+(1.013)+(1.033), (I-749)+(1.013)+(1.034), (I-749)+(1.013)+(1.035), (I-749)+(1.013)+(1.036), (I-749)+(1.013)+(1.037), (I-749)+(1.013)+(1.038), (I-749)+(1.013)+(1.039), (I-749)+(1.013)+(1.040), (I-749)+(1.013)+(1.041), (I-749)+(1.013)+(1.042), (I-749)+(1.013)+(1.043), (I-749)+(1.013)+(1.044), (I-749)+(1.013)+(1.045), (I-749)+(1.013)+(1.046), (I-749)+(1.013)+(1.047), (I-749)+(1.013)+(1.048), (I-749)+(1.013)+(1.049), (I-749)+(1.013)+(1.050), (I-749)+(1.013)+(1.051), (I-749)+(1.013)+(1.052), (I-749)+(1.013)+(1.053), (I-749)+(1.013)+(1.054), (I-749)+(1.013)+(1.055), (I-749)+(1.013)+(1.056), (I-749)+(1.013)+(1.057), (I-749)+(1.013)+(1.058), (I-749)+(1.013)+(1.059), (I-749)+(1.013)+(1.060), (I-749)+(1.013)+(1.061), (I-749)+(1.013)+(1.062), (I-749)+(1.013)+(1.063), (I-749)+(1.013)+(1.064), (I-749)+(1.013)+(1.065), (I-749)+(1.013)+(1.066), (I-749)+(1.013)+(1.067), (I-749)+(1.013)+(1.068), (I-749)+(1.013)+(1.069), (I-749)+(1.013)+(1.070), (I-749)+(1.013)+(1.071), (I-749)+(1.013)+(1.072), (I-749)+(1.013)+(1.073), (I-749)+(1.013)+(1.074), (I-749)+(1.013)+(1.075), (I-749)+(1.013)+(1.076), (I-749)+(1.013)+(1.077), (I-749)+(1.013)+(1.078), (I-749)+(1.013)+(1.079), (I-749)+(1.013)+(1.080), (I-749)+(1.013)+(1.081), (I-749)+(1.013)+(1.082), (I-749)+(1.013)+(1.083), (I-749)+(1.013)+(1.084), (I-749)+(1.013)+(1.085), (I-749)+(1.013)+(1.086), (I-749)+(1.013)+(1.087), (I-749)+(1.013)+(1.088), (I-749)+(1.013)+(1.089), (I-749)+(1.013)+(1.090), (I-749)+(1.013)+(1.091), (I-749)+(1.013)+(1.092), (I-749)+(1.013)+(2.001), (I-749)+(1.013)+(2.002), (I-749)+(1.013)+(2.003), (I-749)+(1.013)+(2.004), (I-749)+(1.013)+(2.005), (I-749)+(1.013)+(2.006), (I-749)+(1.013)+(2.007), (I-749)+(1.013)+(2.008), (I-749)+(1.013)+(2.009), (I-749)+(1.013)+(2.010), (I-749)+(1.013)+(2.011), (I-749)+(1.013)+(2.012), (I-749)+(1.013)+(2.013), (I-749)+(1.013)+(2.014), (I-749)+(1.013)+(2.015), (I-749)+(1.013)+(2.016), (I-749)+(1.013)+(2.017), (I-749)+(1.013)+(2.018), (I-749)+(1.013)+(2.019), (I-749)+(1.013)+(2.020), (I-749)+(1.013)+(2.021), (I-749)+(1.013)+(2.022), (I-749)+(1.013)+(2.023), (I-749)+(1.013)+(2.024), (I-749)+(1.013)+(2.025), (I-749)+(1.013)+(2.026), (I-749)+(1.013)+(2.027), (I-749)+(1.013)+(2.028), (I-749)+(1.013)+(2.029), (I-749)+(1.013)+(2.030), (I-749)+(1.013)+(2.031), (I-749)+(1.013)+(2.032), (I-749)+(1.013)+(2.033), (I-749)+(1.013)+(2.034), (I-749)+(1.013)+(2.035), (I-749)+(1.013)+(2.036), (I-749)+(1.013)+(2.037), (I-749)+(1.013)+(2.038), (I-749)+(1.013)+(2.039), (I-749)+(1.013)+(2.040), (I-749)+(1.013)+(2.041), (I-749)+(1.013)+(2.042), (I-749)+(1.013)+(2.043), (I-749)+(1.013)+(2.044), (I-749)+(1.013)+(2.045), (I-749)+(1.013)+(2.046), (I-749)+(1.013)+(2.047), (I-749)+(1.013)+(2.048), (I-749)+(1.013)+(2.049), (I-749)+(1.013)+(2.050), (I-749)+(1.013)+(2.051), (I-749)+(1.013)+(2.052), (I-749)+(1.013)+(2.053), (I-749)+(1.013)+(2.054), (I-749)+(1.013)+(2.055), (I-749)+(1.013)+(2.056), (I-749)+(1.013)+(2.057), (I-749)+(1.013)+(2.058), (I-749)+(1.013)+(2.059), (I-749)+(1.013)+(3.001), (I-749)+(1.013)+(3.002), (I-749)+(1.013)+(3.003), (I-749)+(1.013)+(3.004), (I-749)+(1.013)+(3.005), (I-749)+(1.013)+(3.006), (I-749)+(1.013)+(3.007), (I-749)+(1.013)+(3.008), (I-749)+(1.013)+(3.009), (I-749)+(1.013)+(3.010), (I-749)+(1.013)+(3.011), (I-749)+(1.013)+(3.012), (I-749)+(1.013)+(3.013), (I-749)+(1.013)+(3.014), (I-749)+(1.013)+(3.015), (I-749)+(1.013)+(3.016), (I-749)+(1.013)+(3.017), (I-749)+(1.013)+(3.018), (I-749)+(1.013)+(3.019), (I-749)+(1.013)+(3.020), (I-749)+(1.013)+(3.021), (I-749)+(1.013)+(3.022), (I-749)+(1.013)+(3.023), (I-749)+(1.013)+(3.024), (I-749)+(1.013)+(3.025), (I-749)+(1.013)+(3.026), (I-749)+(1.013)+(3.027), (I-749)+(1.013)+(3.028), (I-749)+(1.013)+(3.029), (I-749)+(1.013)+(3.030), (I-749)+(1.013)+(3.031), (I-749)+(1.013)+(5.001), (I-749)+(1.013)+(5.002), (I-749)+(1.013)+(5.003), (I-749)+(1.013)+(5.004), (I-749)+(1.013)+(5.005), (I-749)+(1.013)+(5.006), (I-749)+(1.013)+(5.007), (I-749)+(1.013)+(5.008), (I-749)+(1.013)+(5.009), (I-749)+(1.013)+(5.010), (I-749)+(1.013)+(5.011), (I-749)+(1.013)+(5.012), (I-749)+(1.013)+(5.013), (I-749)+(1.013)+(5.014), (I-749)+(1.013)+(5.015), (I-749)+(1.013)+(5.016), (I-749)+(1.013)+(5.017), (I-749)+(1.013)+(5.018), (I-749)+(1.013)+(5.019), (I-749)+(1.013)+(5.020), (I-749)+(1.013)+(5.021), (I-749)+(1.013)+(5.022), (I-749)+(1.013)+(5.023), (I-749)+(1.013)+(6.001), (I-749)+(1.013)+(6.002), (I-749)+(1.013)+(6.003), (I-749)+(1.013)+(6.004), (I-749)+(1.013)+(7.001), (I-749)+(1.013)+(7.002), (I-749)+(1.013)+(7.003), (I-749)+(1.013)+(7.004), (I-749)+(1.013)+(7.005), (I-749)+(1.013)+(7.006), (I-749)+(1.013)+(9.001), (I-749)+(1.013)+(9.002), (I-749)+(1.013)+(9.003), (I-749)+(1.013)+(9.004), (I-749)+(1.013)+(9.005), (I-749)+(1.013)+(9.006), (I-749)+(1.013)+(9.007), (I-749)+(1.013)+(9.008), (I-749)+(1.013)+(9.009), (I-749)+(1.013)+(14.001), (I-749)+(1.013)+(14.002), (I-749)+(1.013)+(15.008), (I-749)+(1.013)+(15.011), (I-749)+(1.013)+(15.012), (I-749)+(1.013)+(15.016), (I-749)+(1.013)+(15.025), (I-749)+(1.013)+(15.027), (I-749)+(1.013)+(15.047), (I-749)+(1.013)+(15.063), (I-749)+(1.013)+(15.064), (I-749)+(1.013)+(16.001), (I-749)+(1.013)+(16.002), (I-749)+(1.013)+(16.003), (I-749)+(1.013)+(16.004), (I-749)+(1.013)+(16.005), (I-749)+(1.013)+(16.006), (I-749)+(1.013)+(16.007), (I-749)+(1.013)+(16.008), (I-749)+(1.013)+(17.001), (I-749)+(1.013)+(17.002), (I-749)+(1.013)+(17.003), (I-749)+(1.013)+(17.004), (I-749)+(1.013)+(17.005), (I-749)+(1.013)+(17.006), (I-749)+(1.013)+(17.007), (I-749)+(1.013)+(17.008), (I-749)+(1.013)+(17.009), (I-749)+(1.013)+(17.010), (I-749)+(1.013)+(17.011), (I-749)+(1.013)+(17.012), (I-749)+(1.013)+(18.001),

(I-749)+(1.014)+(1.015), (I-749)+(1.014)+(1.016), (I-749)+(1.014)+(1.017), (I-749)+(1.014)+(1.018), (I-749)+(1.014)+(1.019), (I-749)+(1.014)+(1.020), (I-749)+(1.014)+(1.021), (I-749)+(1.014)+(1.022), (I-749)+(1.014)+(1.023), (I-749)+(1.014)+(1.024), (I-749)+(1.014)+(1.025), (I-749)+(1.014)+(1.026), (I-749)+(1.014)+(1.027), (I-749)+(1.014)+(1.028), (I-749)+(1.014)+(1.029), (I-749)+(1.014)+(1.030), (I-749)+(1.014)+(1.031), (I-749)+(1.014)+(1.032), (I-749)+(1.014)+(1.033), (I-749)+(1.014)+(1.034), (I-749)+(1.014)+(1.035), (I-749)+(1.014)+(1.036), (I-749)+(1.014)+(1.037), (I-749)+(1.014)+(1.038), (I-749)+(1.014)+(1.039), (I-749)+(1.014)+(1.040), (I-749)+(1.014)+(1.041), (I-749)+(1.014)+(1.042), (I-749)+(1.014)+(1.043), (I-749)+(1.014)+(1.044), (I-749)+(1.014)+(1.045), (I-749)+(1.014)+(1.046), (I-749)+(1.014)+(1.047), (I-749)+(1.014)+(1.048), (I-749)+(1.014)+(1.049), (I-749)+(1.014)+(1.050), (I-749)+(1.014)+(1.051), (I-749)+(1.014)+(1.052), (I-749)+(1.014)+(1.053), (I-749)+(1.014)+(1.054), (I-749)+(1.014)+(1.055), (I-749)+(1.014)+(1.056), (I-749)+(1.014)+(1.057), (I-749)+(1.014)+(1.058), (I-749)+(1.014)+(1.059), (I-749)+(1.014)+(1.060), (I-749)+(1.014)+(1.061), (I-749)+(1.014)+(1.062), (I-749)+(1.014)+(1.063), (I-749)+(1.014)+(1.064), (I-749)+(1.014)+(1.065), (I-749)+(1.014)+(1.066), (I-749)+(1.014)+(1.067), (I-749)+(1.014)+(1.068), (I-749)+(1.014)+(1.069), (I-749)+(1.014)+(1.070), (I-749)+(1.014)+(1.071), (I-749)+(1.014)+(1.072), (I-749)+(1.014)+(1.073), (I-749)+(1.014)+(1.074), (I-749)+(1.014)+(1.075), (I-749)+(1.014)+(1.076), (I-749)+(1.014)+(1.077), (I-749)+(1.014)+(1.078), (I-749)+(1.014)+(1.079), (I-749)+(1.014)+(1.080), (I-749)+(1.014)+(1.081), (I-749)+(1.014)+(1.082), (I-749)+(1.014)+(1.083), (I-749)+(1.014)+(1.084), (I-749)+(1.014)+(1.085), (I-749)+(1.014)+(1.086), (I-749)+(1.014)+(1.087), (I-749)+(1.014)+(1.088), (I-749)+(1.014)+(1.089), (I-749)+(1.014)+(1.090), (I-749)+(1.014)+(1.091), (I-749)+(1.014)+(1.092), (I-749)+(1.014)+(2.001), (I-749)+(1.014)+(2.002), (I-749)+(1.014)+(2.003), (I-749)+(1.014)+(2.004), (I-749)+(1.014)+(2.005), (I-749)+(1.014)+(2.006), (I-749)+(1.014)+(2.007), (I-749)+(1.014)+(2.008), (I-749)+(1.014)+(2.009), (I-749)+(1.014)+(2.010), (I-749)+(1.014)+(2.011), (I-749)+(1.014)+(2.012), (I-749)+(1.014)+(2.013), (I-749)+(1.014)+(2.014), (I-749)+(1.014)+(2.015), (I-749)+(1.014)+(2.016), (I-749)+(1.014)+(2.017), (I-749)+(1.014)+(2.018), (I-749)+(1.014)+(2.019), (I-749)+(1.014)+(2.020), (I-749)+(1.014)+(2.021), (I-749)+(1.014)+(2.022), (I-749)+(1.014)+(2.023), (I-749)+(1.014)+(2.024), (I-749)+(1.014)+(2.025), (I-749)+(1.014)+(2.026), (I-749)+(1.014)+(2.027), (I-749)+(1.014)+(2.028), (I-749)+(1.014)+(2.029), (I-749)+(1.014)+(2.030), (I-749)+(1.014)+(2.031), (I-749)+(1.014)+(2.032), (I-749)+(1.014)+(2.033), (I-749)+(1.014)+(2.034), (I-749)+(1.014)+(2.035), (I-749)+(1.014)+(2.036), (I-749)+(1.014)+(2.037), (I-749)+(1.014)+(2.038), (I-749)+(1.014)+(2.039), (I-749)+(1.014)+(2.040), (I-749)+(1.014)+(2.041), (I-749)+(1.014)+(2.042), (I-749)+(1.014)+(2.043), (I-749)+(1.014)+(2.044), (I-749)+(1.014)+(2.045), (I-749)+(1.014)+(2.046), (I-749)+(1.014)+(2.047), (I-749)+(1.014)+(2.048), (I-749)+(1.014)+(2.049), (I-749)+(1.014)+(2.050), (I-749)+(1.014)+(2.051), (I-749)+(1.014)+(2.052), (I-749)+(1.014)+(2.053), (I-749)+(1.014)+(2.054), (I-749)+(1.014)+(2.055), (I-749)+(1.014)+(2.056), (I-749)+(1.014)+(2.057), (I-749)+(1.014)+(2.058), (I-749)+(1.014)+(2.059), (I-749)+(1.014)+(3.001), (I-749)+(1.014)+(3.002), (I-749)+(1.014)+(3.003), (I-749)+(1.014)+(3.004), (I-749)+(1.014)+(3.005), (I-749)+(1.014)+(3.006), (I-749)+(1.014)+(3.007), (I-749)+(1.014)+(3.008), (I-749)+(1.014)+(3.009), (I-749)+(1.014)+(3.010), (I-749)+(1.014)+(3.011), (I-749)+(1.014)+(3.012), (I-749)+(1.014)+(3.013), (I-749)+(1.014)+(3.014), (I-749)+(1.014)+(3.015), (I-749)+(1.014)+(3.016), (I-749)+(1.014)+(3.017), (I-749)+(1.014)+(3.018), (I-749)+(1.014)+(3.019), (I-749)+(1.014)+(3.020), (I-749)+(1.014)+(3.021), (I-749)+(1.014)+(3.022), (I-749)+(1.014)+(3.023), (I-749)+(1.014)+(3.024), (I-749)+(1.014)+(3.025), (I-749)+(1.014)+(3.026), (I-749)+(1.014)+(3.027), (I-749)+(1.014)+(3.028), (I-749)+(1.014)+(3.029), (I-749)+(1.014)+(3.030), (I-749)+(1.014)+(3.031), (I-749)+(1.014)+(5.001), (I-749)+(1.014)+(5.002), (I-749)+(1.014)+(5.003), (I-749)+(1.014)+(5.004), (I-749)+(1.014)+(5.005), (I-749)+(1.014)+(5.006), (I-749)+(1.014)+(5.007), (I-749)+(1.014)+(5.008), (I-749)+(1.014)+(5.009), (I-749)+(1.014)+(5.010), (I-749)+(1.014)+(5.011), (I-749)+(1.014)+(5.012), (I-749)+(1.014)+(5.013), (I-749)+(1.014)+(5.014), (I-749)+(1.014)+(5.015), (I-749)+(1.014)+(5.016), (I-749)+(1.014)+(5.017), (I-749)+(1.014)+(5.018), (I-749)+(1.014)+(5.019), (I-749)+(1.014)+(5.020), (I-749)+(1.014)+(5.021), (I-749)+(1.014)+(5.022), (I-749)+(1.014)+(5.023), (I-749)+(1.014)+(6.001), (I-749)+(1.014)+(6.002), (I-749)+(1.014)+(6.003), (I-749)+(1.014)+(6.004), (I-749)+(1.014)+(7.001), (I-749)+(1.014)+(7.002), (I-749)+(1.014)+(7.003), (I-749)+(1.014)+(7.004), (I-749)+(1.014)+(7.005), (I-749)+(1.014)+(7.006), (I-749)+(1.014)+(9.001), (I-749)+(1.014)+(9.002), (I-749)+(1.014)+(9.003), (I-749)+(1.014)+(9.004), (I-749)+(1.014)+(9.005), (I-749)+(1.014)+(9.006), (I-749)+(1.014)+(9.007), (I-749)+(1.014)+(9.008), (I-749)+(1.014)+(9.009), (I-749)+(1.014)+(14.001), (I-749)+(1.014)+(14.002), (I-749)+(1.014)+(15.008), (I-749)+(1.014)+(15.011), (I-749)+(1.014)+(15.012), (I-749)+(1.014)+(15.016), (I-749)+(1.014)+(15.025), (I-749)+(1.014)+(15.027), (I-749)+(1.014)+(15.047), (I-749)+(1.014)+(15.063), (I-749)+(1.014)+(15.064), (I-749)+(1.014)+(16.001), (I-749)+(1.014)+(16.002), (I-749)+(1.014)+(16.003), (I-749)+(1.014)+(16.004), (I-749)+(1.014)+(16.005), (I-749)+(1.014)+(16.006), (I-749)+(1.014)+(16.007), (I-749)+(1.014)+(16.008), (I-749)+(1.014)+(17.001), (I-749)+(1.014)+(17.002), (I-749)+(1.014)+(17.003), (I-749)+(1.014)+(17.004), (I-749)+(1.014)+(17.005), (I-749)+(1.014)+(17.006), (I-749)+(1.014)+(17.007), (I-749)+(1.014)+(17.008), (I-749)+(1.014)+(17.009), (I-749)+(1.014)+(17.010), (I-749)+(1.014)+(17.011), (I-749)+(1.014)+(17.012), (I-749)+(1.014)+(18.001),

(I-749)+(1.015)+(1.016), (I-749)+(1.015)+(1.017), (I-749)+(1.015)+(1.018), (I-749)+(1.015)+(1.019), (I-749)+(1.015)+(1.020), (I-749)+(1.015)+(1.021), (I-749)+(1.015)+(1.022), (I-749)+(1.015)+(1.023), (I-749)+(1.015)+(1.024), (I-749)+(1.015)+(1.025), (I-749)+(1.015)+(1.026), (I-749)+(1.015)+(1.027), (I-749)+(1.015)+(1.028), (I-749)+(1.015)+(1.029), (I-749)+(1.015)+(1.030), (I-749)+(1.015)+(1.031), (I-749)+(1.015)+(1.032), (I-749)+(1.015)+(1.033), (I-749)+(1.015)+(1.034), (I-749)+(1.015)+(1.035), (I-749)+(1.015)+(1.036), (I-749)+(1.015)+(1.037), (I-749)+(1.015)+(1.038), (I-749)+(1.015)+(1.039), (I-749)+(1.015)+(1.040), (I-749)+(1.015)+(1.041), (I-749)+(1.015)+(1.042), (I-749)+(1.015)+(1.043), (I-749)+(1.015)+(1.044), (I-749)+(1.015)+(1.045), (I-749)+(1.015)+(1.046), (I-749)+(1.015)+(1.047), (I-749)+(1.015)+(1.048), (I-749)+(1.015)+(1.049), (I-749)+(1.015)+(1.050), (I-749)+(1.015)+(1.051), (I-749)+(1.015)+(1.052), (I-749)+(1.015)+(1.053), (I-749)+(1.015)+(1.054), (I-749)+(1.015)+(1.055), (I-749)+(1.015)+(1.056), (I-749)+(1.015)+(1.057), (I-749)+(1.015)+(1.058), (I-749)+(1.015)+(1.059), (I-749)+(1.015)+(1.060), (I-749)+(1.015)+(1.061), (I-749)+(1.015)+(1.062), (I-749)+(1.015)+(1.063), (I-749)+(1.015)+(1.064), (I-749)+(1.015)+(1.065), (I-749)+(1.015)+(1.066), (I-749)+(1.015)+(1.067), (I-749)+(1.015)+(1.068), (I-749)+(1.015)+(1.069), (I-749)+(1.015)+(1.070), (I-749)+(1.015)+(1.071), (I-749)+(1.015)+(1.072), (I-749)+(1.015)+(1.073), (I-749)+(1.015)+(1.074), (I-749)+(1.015)+(1.075), (I-749)+(1.015)+(1.076), (I-749)+(1.015)+(1.077), (I-749)+(1.015)+(1.078), (I-749)+(1.015)+(1.079), (I-749)+(1.015)+(1.080), (I-749)+(1.015)+(1.081), (I-749)+(1.015)+(1.082), (I-749)+(1.015)+(1.083), (I-749)+(1.015)+(1.084), (I-749)+(1.015)+(1.085), (I-749)+(1.015)+(1.086), (I-749)+(1.015)+(1.087), (I-749)+(1.015)+(1.088), (I-749)+(1.015)+(1.089), (I-749)+(1.015)+(1.090), (I-749)+(1.015)+(1.091), (I-749)+(1.015)+(1.092), (I-749)+(1.015)+(2.001), (I-749)+(1.015)+(2.002), (I-749)+(1.015)+(2.003), (I-749)+(1.015)+(2.004), (I-749)+(1.015)+(2.005), (I-749)+(1.015)+(2.006), (I-749)+(1.015)+(2.007), (I-749)+(1.015)+(2.008), (I-749)+(1.015)+(2.009), (I-749)+(1.015)+(2.010), (I-749)+(1.015)+(2.011), (I-749)+(1.015)+(2.012), (I-749)+(1.015)+(2.013), (I-749)+(1.015)+(2.014), (I-749)+(1.015)+(2.015), (I-749)+(1.015)+(2.016), (I-749)+(1.015)+(2.017), (I-749)+(1.015)+(2.018), (I-749)+(1.015)+(2.019), (I-749)+(1.015)+(2.020), (I-749)+(1.015)+(2.021), (I-749)+(1.015)+(2.022), (I-749)+(1.015)+(2.023), (I-749)+(1.015)+(2.024), (I-749)+(1.015)+(2.025), (I-749)+(1.015)+(2.026), (I-749)+(1.015)+(2.027), (I-749)+(1.015)+(2.028), (I-749)+(1.015)+(2.029), (I-749)+(1.015)+(2.030), (I-749)+(1.015)+(2.031), (I-749)+(1.015)+(2.032), (I-749)+(1.015)+(2.033), (I-749)+(1.015)+(2.034), (I-749)+(1.015)+(2.035), (I-749)+(1.015)+(2.036), (I-749)+(1.015)+(2.037), (I-749)+(1.015)+(2.038), (I-749)+(1.015)+(2.039), (I-749)+(1.015)+(2.040), (I-749)+(1.015)+(2.041), (I-749)+(1.015)+(2.042), (I-749)+(1.015)+(2.043), (I-749)+(1.015)+(2.044), (I-749)+(1.015)+(2.045), (I-749)+(1.015)+(2.046), (I-749)+(1.015)+(2.047), (I-749)+(1.015)+(2.048), (I-749)+(1.015)+(2.049), (I-749)+(1.015)+(2.050), (I-749)+(1.015)+(2.051), (I-749)+(1.015)+(2.052), (I-749)+(1.015)+(2.053), (I-749)+(1.015)+(2.054), (I-749)+(1.015)+(2.055), (I-749)+(1.015)+(2.056), (I-749)+(1.015)+(2.057), (I-749)+(1.015)+(2.058), (I-749)+(1.015)+(2.059), (I-749)+(1.015)+(3.001), (I-749)+(1.015)+(3.002), (I-749)+(1.015)+(3.003), (I-749)+(1.015)+(3.004), (I-749)+(1.015)+(3.005), (I-749)+(1.015)+(3.006), (I-749)+(1.015)+(3.007), (I-749)+(1.015)+(3.008), (I-749)+(1.015)+(3.009), (I-749)+(1.015)+(3.010), (I-749)+(1.015)+(3.011), (I-749)+(1.015)+(3.012), (I-749)+(1.015)+(3.013), (I-749)+(1.015)+(3.014), (I-749)+(1.015)+(3.015), (I-749)+(1.015)+(3.016), (I-749)+(1.015)+(3.017), (I-749)+(1.015)+(3.018), (I-749)+(1.015)+(3.019), (I-749)+(1.015)+(3.020), (I-749)+(1.015)+(3.021), (I-749)+(1.015)+(3.022), (I-749)+(1.015)+(3.023), (I-749)+(1.015)+(3.024), (I-749)+(1.015)+(3.025), (I-749)+(1.015)+(3.026), (I-749)+(1.015)+(3.027), (I-749)+(1.015)+(3.028), (I-749)+(1.015)+(3.029), (I-749)+(1.015)+(3.030), (I-749)+(1.015)+(3.031), (I-749)+(1.015)+(5.001), (I-749)+(1.015)+(5.002), (I-749)+(1.015)+(5.003), (I-749)+(1.015)+(5.004), (I-749)+(1.015)+(5.005), (I-749)+(1.015)+(5.006), (I-749)+(1.015)+(5.007), (I-749)+(1.015)+(5.008), (I-749)+(1.015)+(5.009), (I-749)+(1.015)+(5.010), (I-749)+(1.015)+(5.011), (I-749)+(1.015)+(5.012), (I-749)+(1.015)+(5.013), (I-749)+(1.015)+(5.014), (I-749)+(1.015)+(5.015), (I-749)+(1.015)+(5.016), (I-749)+(1.015)+(5.017), (I-749)+(1.015)+(5.018), (I-749)+(1.015)+(5.019), (I-749)+(1.015)+(5.020), (I-749)+(1.015)+(5.021), (I-749)+(1.015)+(5.022), (I-749)+(1.015)+(5.023), (I-749)+(1.015)+(6.001), (I-749)+(1.015)+(6.002), (I-749)+(1.015)+(6.003), (I-749)+(1.015)+(6.004), (I-749)+(1.015)+(7.001), (I-749)+(1.015)+(7.002), (I-749)+(1.015)+(7.003), (I-749)+(1.015)+(7.004), (I-749)+(1.015)+(7.005), (I-749)+(1.015)+(7.006), (I-749)+(1.015)+(9.001), (I-749)+(1.015)+(9.002), (I-749)+(1.015)+(9.003), (I-749)+(1.015)+(9.004), (I-749)+(1.015)+(9.005), (I-749)+(1.015)+(9.006), (I-749)+(1.015)+(9.007), (I-749)+(1.015)+(9.008), (I-749)+(1.015)+(9.009), (I-749)+(1.015)+(14.001), (I-749)+(1.015)+(14.002), (I-749)+(1.015)+(15.008), (I-749)+(1.015)+(15.011), (I-749)+(1.015)+(15.012), (I-749)+(1.015)+(15.016), (I-749)+(1.015)+(15.025), (I-749)+(1.015)+(15.027), (I-749)+(1.015)+(15.047), (I-749)+(1.015)+(15.063), (I-749)+(1.015)+(15.064), (I-749)+(1.015)+(16.001), (I-749)+(1.015)+(16.002), (I-749)+(1.015)+(16.003), (I-749)+(1.015)+(16.004), (I-749)+(1.015)+(16.005), (I-749)+(1.015)+(16.006), (I-749)+(1.015)+(16.007), (I-749)+(1.015)+(16.008), (I-749)+(1.015)+(17.001), (I-749)+(1.015)+(17.002), (I-749)+(1.015)+(17.003), (I-749)+(1.015)+(17.004), (I-749)+(1.015)+(17.005), (I-749)+(1.015)+(17.006), (I-749)+(1.015)+(17.007), (I-749)+(1.015)+(17.008), (I-749)+(1.015)+(17.009), (I-749)+(1.015)+(17.010), (I-749)+(1.015)+(17.011), (I-749)+(1.015)+(17.012), (I-749)+(1.015)+(18.001),

(I-749)+(1.016)+(1.017), (I-749)+(1.016)+(1.018), (I-749)+(1.016)+(1.019), (I-749)+(1.016)+(1.020), (I-749)+(1.016)+(1.021), (I-749)+(1.016)+(1.022), (I-749)+(1.016)+(1.023), (I-749)+(1.016)+(1.024), (I-749)+(1.016)+(1.025), (I-749)+(1.016)+(1.026), (I-749)+(1.016)+(1.027), (I-749)+(1.016)+(1.028), (I-749)+(1.016)+(1.029), (I-749)+(1.016)+(1.030), (I-749)+(1.016)+(1.031), (I-749)+(1.016)+(1.032), (I-749)+(1.016)+(1.033), (I-749)+(1.016)+(1.034), (I-749)+(1.016)+(1.035), (I-749)+(1.016)+(1.036), (I-749)+(1.016)+(1.037), (I-749)+(1.016)+(1.038), (I-749)+(1.016)+(1.039), (I-749)+(1.016)+(1.040), (I-749)+(1.016)+(1.041), (I-749)+(1.016)+(1.042), (I-749)+(1.016)+(1.043), (I-749)+(1.016)+(1.044), (I-749)+(1.016)+(1.045), (I-749)+(1.016)+(1.046), (I-749)+(1.016)+(1.047), (I-749)+(1.016)+(1.048), (I-749)+(1.016)+(1.049), (I-749)+(1.016)+(1.050), (I-749)+(1.016)+(1.051), (I-749)+(1.016)+(1.052), (I-749)+(1.016)+(1.053), (I-749)+(1.016)+(1.054), (I-749)+(1.016)+(1.055), (I-749)+(1.016)+(1.056), (I-749)+(1.016)+(1.057), (I-749)+(1.016)+(1.058), (I-749)+(1.016)+(1.059), (I-749)+(1.016)+(1.060), (I-749)+(1.016)+(1.061), (I-749)+(1.016)+(1.062), (I-749)+(1.016)+(1.063), (I-749)+(1.016)+(1.064), (I-749)+(1.016)+(1.065), (I-749)+(1.016)+(1.066), (I-749)+(1.016)+(1.067), (I-749)+(1.016)+(1.068), (I-749)+(1.016)+(1.069), (I-749)+(1.016)+(1.070), (I-749)+(1.016)+(1.071), (I-749)+(1.016)+(1.072), (I-749)+(1.016)+(1.073), (I-749)+(1.016)+(1.074), (I-749)+(1.016)+(1.075), (I-749)+(1.016)+(1.076), (I-749)+(1.016)+(1.077), (I-749)+(1.016)+(1.078), (I-749)+(1.016)+(1.079), (I-749)+(1.016)+(1.080), (I-749)+(1.016)+(1.081), (I-749)+(1.016)+(1.082), (I-749)+(1.016)+(1.083), (I-749)+(1.016)+(1.084), (I-749)+(1.016)+(1.085), (I-749)+(1.016)+(1.086), (I-749)+(1.016)+(1.087), (I-749)+(1.016)+(1.088), (I-749)+(1.016)+(1.089), (I-749)+(1.016)+(1.090), (I-749)+(1.016)+(1.091), (I-749)+(1.016)+(1.092), (I-749)+(1.016)+(2.001), (I-749)+(1.016)+(2.002), (I-749)+(1.016)+(2.003), (I-749)+(1.016)+(2.004), (I-749)+(1.016)+(2.005), (I-749)+(1.016)+(2.006), (I-749)+(1.016)+(2.007), (I-749)+(1.016)+(2.008), (I-749)+(1.016)+(2.009), (I-749)+(1.016)+(2.010), (I-749)+(1.016)+(2.011), (I-749)+(1.016)+(2.012), (I-749)+(1.016)+(2.013), (I-749)+(1.016)+(2.014), (I-749)+(1.016)+(2.015), (I-749)+(1.016)+(2.016), (I-749)+(1.016)+(2.017), (I-749)+(1.016)+(2.018), (I-749)+(1.016)+(2.019), (I-749)+(1.016)+(2.020), (I-749)+(1.016)+(2.021), (I-749)+(1.016)+(2.022), (I-749)+(1.016)+(2.023), (I-749)+(1.016)+(2.024), (I-749)+(1.016)+(2.025), (I-749)+(1.016)+(2.026), (I-749)+(1.016)+(2.027), (I-749)+(1.016)+(2.028), (I-749)+(1.016)+(2.029), (I-749)+(1.016)+(2.030), (I-749)+(1.016)+(2.031), (I-749)+(1.016)+(2.032), (I-749)+(1.016)+(2.033), (I-749)+(1.016)+(2.034), (I-749)+(1.016)+(2.035), (I-749)+(1.016)+(2.036), (I-749)+(1.016)+(2.037), (I-749)+(1.016)+(2.038), (I-749)+(1.016)+(2.039), (I-749)+(1.016)+(2.040), (I-749)+(1.016)+(2.041), (I-749)+(1.016)+(2.042), (I-749)+(1.016)+(2.043), (I-749)+(1.016)+(2.044), (I-749)+(1.016)+(2.045), (I-749)+(1.016)+(2.046), (I-749)+(1.016)+(2.047), (I-749)+(1.016)+(2.048), (I-749)+(1.016)+(2.049), (I-749)+(1.016)+(2.050), (I-749)+(1.016)+(2.051), (I-749)+(1.016)+(2.052), (I-749)+(1.016)+(2.053), (I-749)+(1.016)+(2.054), (I-749)+(1.016)+(2.055), (I-749)+(1.016)+(2.056), (I-749)+(1.016)+(2.057), (I-749)+(1.016)+(2.058), (I-749)+(1.016)+(2.059), (I-749)+(1.016)+(3.001), (I-749)+(1.016)+(3.002), (I-749)+(1.016)+(3.003), (I-749)+(1.016)+(3.004), (I-749)+(1.016)+(3.005), (I-749)+(1.016)+(3.006), (I-749)+(1.016)+(3.007), (I-749)+(1.016)+(3.008), (I-749)+(1.016)+(3.009), (I-749)+(1.016)+(3.010), (I-749)+(1.016)+(3.011), (I-749)+(1.016)+(3.012), (I-749)+(1.016)+(3.013), (I-749)+(1.016)+(3.014), (I-749)+(1.016)+(3.015), (I-749)+(1.016)+(3.016), (I-749)+(1.016)+(3.017), (I-749)+(1.016)+(3.018), (I-749)+(1.016)+(3.019), (I-749)+(1.016)+(3.020), (I-749)+(1.016)+(3.021), (I-749)+(1.016)+(3.022), (I-749)+(1.016)+(3.023), (I-749)+(1.016)+(3.024), (I-749)+(1.016)+(3.025), (I-749)+(1.016)+(3.026), (I-749)+(1.016)+(3.027), (I-749)+(1.016)+(3.028), (I-749)+(1.016)+(3.029), (I-749)+(1.016)+(3.030), (I-749)+(1.016)+(3.031), (I-749)+(1.016)+(5.001), (I-749)+(1.016)+(5.002), (I-749)+(1.016)+(5.003), (I-749)+(1.016)+(5.004), (I-749)+(1.016)+(5.005), (I-749)+(1.016)+(5.006), (I-749)+(1.016)+(5.007), (I-749)+(1.016)+(5.008), (I-749)+(1.016)+(5.009), (I-749)+(1.016)+(5.010), (I-749)+(1.016)+(5.011), (I-749)+(1.016)+(5.012), (I-749)+(1.016)+(5.013), (I-749)+(1.016)+(5.014), (I-749)+(1.016)+(5.015), (I-749)+(1.016)+(5.016), (I-749)+(1.016)+(5.017), (I-749)+(1.016)+(5.018), (I-749)+(1.016)+(5.019), (I-749)+(1.016)+(5.020), (I-749)+(1.016)+(5.021), (I-749)+(1.016)+(5.022), (I-749)+(1.016)+(5.023), (I-749)+(1.016)+(6.001), (I-749)+(1.016)+(6.002), (I-749)+(1.016)+(6.003), (I-749)+(1.016)+(6.004), (I-749)+(1.016)+(7.001), (I-749)+(1.016)+(7.002), (I-749)+(1.016)+(7.003), (I-749)+(1.016)+(7.004), (I-749)+(1.016)+(7.005), (I-749)+(1.016)+(7.006), (I-749)+(1.016)+(9.001), (I-749)+(1.016)+(9.002), (I-749)+(1.016)+(9.003), (I-749)+(1.016)+(9.004), (I-749)+(1.016)+(9.005), (I-749)+(1.016)+(9.006), (I-749)+(1.016)+(9.007), (I-749)+(1.016)+(9.008), (I-749)+(1.016)+(9.009), (I-749)+(1.016)+(14.001), (I-749)+(1.016)+(14.002), (I-749)+(1.016)+(15.008), (I-749)+(1.016)+(15.011), (I-749)+(1.016)+(15.012), (I-749)+(1.016)+(15.016), (I-749)+(1.016)+(15.025), (I-749)+(1.016)+(15.027), (I-749)+(1.016)+(15.047), (I-749)+(1.016)+(15.063), (I-749)+(1.016)+(15.064), (I-749)+(1.016)+(16.001), (I-749)+(1.016)+(16.002), (I-749)+(1.016)+(16.003), (I-749)+(1.016)+(16.004), (I-749)+(1.016)+(16.005), (I-749)+(1.016)+(16.006), (I-749)+(1.016)+(16.007), (I-749)+(1.016)+(16.008), (I-749)+(1.016)+(17.001), (I-749)+(1.016)+(17.002), (I-749)+(1.016)+(17.003), (I-749)+(1.016)+(17.004), (I-749)+(1.016)+(17.005), (I-749)+(1.016)+(17.006), (I-749)+(1.016)+(17.007), (I-749)+(1.016)+(17.008), (I-749)+(1.016)+(17.009), (I-749)+(1.016)+(17.010), (I-749)+(1.016)+(17.011), (I-749)+(1.016)+(17.012), (I-749)+(1.016)+(18.001),

(I-749)+(1.017)+(1.018), (I-749)+(1.017)+(1.019), (I-749)+(1.017)+(1.020), (I-749)+(1.017)+(1.021), (I-749)+(1.017)+(1.022), (I-749)+(1.017)+(1.023), (I-749)+(1.017)+(1.024), (I-749)+(1.017)+(1.025), (I-749)+(1.017)+(1.026), (I-749)+(1.017)+(1.027), (I-749)+(1.017)+(1.028), (I-749)+(1.017)+(1.029), (I-749)+(1.017)+(1.030), (I-749)+(1.017)+(1.031), (I-749)+(1.017)+(1.032), (I-749)+(1.017)+(1.033), (I-749)+(1.017)+(1.034), (I-749)+(1.017)+(1.035), (I-749)+(1.017)+(1.036), (I-749)+(1.017)+(1.037), (I-749)+(1.017)+(1.038), (I-749)+(1.017)+(1.039), (I-749)+(1.017)+(1.040), (I-749)+(1.017)+(1.041), (I-749)+(1.017)+(1.042), (I-749)+(1.017)+(1.043), (I-749)+(1.017)+(1.044), (I-749)+(1.017)+(1.045), (I-749)+(1.017)+(1.046), (I-749)+(1.017)+(1.047), (I-749)+(1.017)+(1.048), (I-749)+(1.017)+(1.049), (I-749)+(1.017)+(1.050), (I-749)+(1.017)+(1.051), (I-749)+(1.017)+(1.052), (I-749)+(1.017)+(1.053), (I-749)+(1.017)+(1.054), (I-749)+(1.017)+(1.055), (I-749)+(1.017)+(1.056), (I-749)+(1.017)+(1.057), (I-749)+(1.017)+(1.058), (I-749)+(1.017)+(1.059), (I-749)+(1.017)+(1.060), (I-749)+(1.017)+(1.061), (I-749)+(1.017)+(1.062), (I-749)+(1.017)+(1.063), (I-749)+(1.017)+(1.064), (I-749)+(1.017)+(1.065), (I-749)+(1.017)+(1.066), (I-749)+(1.017)+(1.067), (I-749)+(1.017)+(1.068), (I-749)+(1.017)+(1.069), (I-749)+(1.017)+(1.070), (I-749)+(1.017)+(1.071), (I-749)+(1.017)+(1.072), (I-749)+(1.017)+(1.073), (I-749)+(1.017)+(1.074), (I-749)+(1.017)+(1.075), (I-749)+(1.017)+(1.076), (I-749)+(1.017)+(1.077), (I-749)+(1.017)+(1.078), (I-749)+(1.017)+(1.079), (I-749)+(1.017)+(1.080), (I-749)+(1.017)+(1.081), (I-749)+(1.017)+(1.082), (I-749)+(1.017)+(1.083), (I-749)+(1.017)+(1.084), (I-749)+(1.017)+(1.085), (I-749)+(1.017)+(1.086), (I-749)+(1.017)+(1.087), (I-749)+(1.017)+(1.088), (I-749)+(1.017)+(1.089), (I-749)+(1.017)+(1.090), (I-749)+(1.017)+(1.091), (I-749)+(1.017)+(1.092), (I-749)+(1.017)+(2.001), (I-749)+(1.017)+(2.002), (I-749)+(1.017)+(2.003), (I-749)+(1.017)+(2.004), (I-749)+(1.017)+(2.005), (I-749)+(1.017)+(2.006), (I-749)+(1.017)+(2.007), (I-749)+(1.017)+(2.008), (I-749)+(1.017)+(2.009), (I-749)+(1.017)+(2.010), (I-749)+(1.017)+(2.011), (I-749)+(1.017)+(2.012), (I-749)+(1.017)+(2.013), (I-749)+(1.017)+(2.014), (I-749)+(1.017)+(2.015), (I-749)+(1.017)+(2.016), (I-749)+(1.017)+(2.017), (I-749)+(1.017)+(2.018), (I-749)+(1.017)+(2.019), (I-749)+(1.017)+(2.020), (I-749)+(1.017)+(2.021), (I-749)+(1.017)+(2.022), (I-749)+(1.017)+(2.023), (I-749)+(1.017)+(2.024), (I-749)+(1.017)+(2.025), (I-749)+(1.017)+(2.026), (I-749)+(1.017)+(2.027), (I-749)+(1.017)+(2.028), (I-749)+(1.017)+(2.029), (I-749)+(1.017)+(2.030), (I-749)+(1.017)+(2.031), (I-749)+(1.017)+(2.032), (I-749)+(1.017)+(2.033), (I-749)+(1.017)+(2.034), (I-749)+(1.017)+(2.035), (I-749)+(1.017)+(2.036), (I-749)+(1.017)+(2.037), (I-749)+(1.017)+(2.038), (I-749)+(1.017)+(2.039), (I-749)+(1.017)+(2.040), (I-749)+(1.017)+(2.041), (I-749)+(1.017)+(2.042), (I-749)+(1.017)+(2.043), (I-749)+(1.017)+(2.044), (I-749)+(1.017)+(2.045), (I-749)+(1.017)+(2.046), (I-749)+(1.017)+(2.047), (I-749)+(1.017)+(2.048), (I-749)+(1.017)+(2.049), (I-749)+(1.017)+(2.050), (I-749)+(1.017)+(2.051), (I-749)+(1.017)+(2.052), (I-749)+(1.017)+(2.053), (I-749)+(1.017)+(2.054), (I-749)+(1.017)+(2.055), (I-749)+(1.017)+(2.056), (I-749)+(1.017)+(2.057), (I-749)+(1.017)+(2.058), (I-749)+(1.017)+(2.059), (I-749)+(1.017)+(3.001), (I-749)+(1.017)+(3.002), (I-749)+(1.017)+(3.003), (I-749)+(1.017)+(3.004), (I-749)+(1.017)+(3.005), (I-749)+(1.017)+(3.006), (I-749)+(1.017)+(3.007), (I-749)+(1.017)+(3.008), (I-749)+(1.017)+(3.009), (I-749)+(1.017)+(3.010), (I-749)+(1.017)+(3.011), (I-749)+(1.017)+(3.012), (I-749)+(1.017)+(3.013), (I-749)+(1.017)+(3.014), (I-749)+(1.017)+(3.015), (I-749)+(1.017)+(3.016), (I-749)+(1.017)+(3.017), (I-749)+(1.017)+(3.018), (I-749)+(1.017)+(3.019), (I-749)+(1.017)+(3.020), (I-749)+(1.017)+(3.021), (I-749)+(1.017)+(3.022), (I-749)+(1.017)+(3.023), (I-749)+(1.017)+(3.024), (I-749)+(1.017)+(3.025), (I-749)+(1.017)+(3.026), (I-749)+(1.017)+(3.027), (I-749)+(1.017)+(3.028), (I-749)+(1.017)+(3.029), (I-749)+(1.017)+(3.030), (I-749)+(1.017)+(3.031), (I-749)+(1.017)+(5.001), (I-749)+(1.017)+(5.002), (I-749)+(1.017)+(5.003), (I-749)+(1.017)+(5.004), (I-749)+(1.017)+(5.005), (I-749)+(1.017)+(5.006), (I-749)+(1.017)+(5.007), (I-749)+(1.017)+(5.008), (I-749)+(1.017)+(5.009), (I-749)+(1.017)+(5.010), (I-749)+(1.017)+(5.011), (I-749)+(1.017)+(5.012), (I-749)+(1.017)+(5.013), (I-749)+(1.017)+(5.014), (I-749)+(1.017)+(5.015), (I-749)+(1.017)+(5.016), (I-749)+(1.017)+(5.017), (I-749)+(1.017)+(5.018), (I-749)+(1.017)+(5.019), (I-749)+(1.017)+(5.020), (I-749)+(1.017)+(5.021), (I-749)+(1.017)+(5.022), (I-749)+(1.017)+(5.023), (I-749)+(1.017)+(6.001), (I-749)+(1.017)+(6.002), (I-749)+(1.017)+(6.003), (I-749)+(1.017)+(6.004), (I-749)+(1.017)+(7.001), (I-749)+(1.017)+(7.002), (I-749)+(1.017)+(7.003), (I-749)+(1.017)+(7.004), (I-749)+(1.017)+(7.005), (I-749)+(1.017)+(7.006), (I-749)+(1.017)+(9.001), (I-749)+(1.017)+(9.002), (I-749)+(1.017)+(9.003), (I-749)+(1.017)+(9.004), (I-749)+(1.017)+(9.005), (I-749)+(1.017)+(9.006), (I-749)+(1.017)+(9.007), (I-749)+(1.017)+(9.008), (I-749)+(1.017)+(9.009), (I-749)+(1.017)+(14.001), (I-749)+(1.017)+(14.002), (I-749)+(1.017)+(15.008), (I-749)+(1.017)+(15.011), (I-749)+(1.017)+(15.012), (I-749)+(1.017)+(15.016), (I-749)+(1.017)+(15.025), (I-749)+(1.017)+(15.027), (I-749)+(1.017)+(15.047), (I-749)+(1.017)+(15.063), (I-749)+(1.017)+(15.064), (I-749)+(1.017)+(16.001), (I-749)+(1.017)+(16.002), (I-749)+(1.017)+(16.003), (I-749)+(1.017)+(16.004), (I-749)+(1.017)+(16.005), (I-749)+(1.017)+(16.006), (I-749)+(1.017)+(16.007), (I-749)+(1.017)+(16.008), (I-749)+(1.017)+(17.001), (I-749)+(1.017)+(17.002), (I-749)+(1.017)+(17.003), (I-749)+(1.017)+(17.004), (I-749)+(1.017)+(17.005), (I-749)+(1.017)+(17.006), (I-749)+(1.017)+(17.007), (I-749)+(1.017)+(17.008), (I-749)+(1.017)+(17.009), (I-749)+(1.017)+(17.010), (I-749)+(1.017)+(17.011), (I-749)+(1.017)+(17.012), (I-749)+(1.017)+(18.001),

(I-749)+(1.018)+(1.019), (I-749)+(1.018)+(1.020), (I-749)+(1.018)+(1.021), (I-749)+(1.018)+(1.022), (I-749)+(1.018)+(1.023), (I-749)+(1.018)+(1.024), (I-749)+(1.018)+(1.025), (I-749)+(1.018)+(1.026), (I-749)+(1.018)+(1.027), (I-749)+(1.018)+(1.028), (I-749)+(1.018)+(1.029), (I-749)+(1.018)+(1.030), (I-749)+(1.018)+(1.031), (I-749)+(1.018)+(1.032), (I-749)+(1.018)+(1.033), (I-749)+(1.018)+(1.034), (I-749)+(1.018)+(1.035), (I-749)+(1.018)+(1.036), (I-749)+(1.018)+(1.037), (I-749)+(1.018)+(1.038), (I-749)+(1.018)+(1.039), (I-749)+(1.018)+(1.040), (I-749)+(1.018)+(1.041), (I-749)+(1.018)+(1.042), (I-749)+(1.018)+(1.043), (I-749)+(1.018)+(1.044), (I-749)+(1.018)+(1.045), (I-749)+(1.018)+(1.046), (I-749)+(1.018)+(1.047), (I-749)+(1.018)+(1.048), (I-749)+(1.018)+(1.049), (I-749)+(1.018)+(1.050), (I-749)+(1.018)+(1.051), (I-749)+(1.018)+(1.052), (I-749)+(1.018)+(1.053), (I-749)+(1.018)+(1.054), (I-749)+(1.018)+(1.055), (I-749)+(1.018)+(1.056), (I-749)+(1.018)+(1.057), (I-749)+(1.018)+(1.058), (I-749)+(1.018)+(1.059), (I-749)+(1.018)+(1.060), (I-749)+(1.018)+(1.061), (I-749)+(1.018)+(1.062), (I-749)+(1.018)+(1.063), (I-749)+(1.018)+(1.064), (I-749)+(1.018)+(1.065), (I-749)+(1.018)+(1.066), (I-749)+(1.018)+(1.067), (I-749)+(1.018)+(1.068), (I-749)+(1.018)+(1.069), (I-749)+(1.018)+(1.070), (I-749)+(1.018)+(1.071), (I-749)+(1.018)+(1.072), (I-749)+(1.018)+(1.073), (I-749)+(1.018)+(1.074), (I-749)+(1.018)+(1.075), (I-749)+(1.018)+(1.076), (I-749)+(1.018)+(1.077), (I-749)+(1.018)+(1.078), (I-749)+(1.018)+(1.079), (I-749)+(1.018)+(1.080), (I-749)+(1.018)+(1.081), (I-749)+(1.018)+(1.082), (I-749)+(1.018)+(1.083), (I-749)+(1.018)+(1.084), (I-749)+(1.018)+(1.085), (I-749)+(1.018)+(1.086), (I-749)+(1.018)+(1.087), (I-749)+(1.018)+(1.088), (I-749)+(1.018)+(1.089), (I-749)+(1.018)+(1.090), (I-749)+(1.018)+(1.091), (I-749)+(1.018)+(1.092), (I-749)+(1.018)+(2.001), (I-749)+(1.018)+(2.002), (I-749)+(1.018)+(2.003), (I-749)+(1.018)+(2.004), (I-749)+(1.018)+(2.005), (I-749)+(1.018)+(2.006), (I-749)+(1.018)+(2.007), (I-749)+(1.018)+(2.008), (I-749)+(1.018)+(2.009), (I-749)+(1.018)+(2.010), (I-749)+(1.018)+(2.011), (I-749)+(1.018)+(2.012), (I-749)+(1.018)+(2.013), (I-749)+(1.018)+(2.014), (I-749)+(1.018)+(2.015), (I-749)+(1.018)+(2.016), (I-749)+(1.018)+(2.017), (I-749)+(1.018)+(2.018), (I-749)+(1.018)+(2.019), (I-749)+(1.018)+(2.020), (I-749)+(1.018)+(2.021), (I-749)+(1.018)+(2.022), (I-749)+(1.018)+(2.023), (I-749)+(1.018)+(2.024), (I-749)+(1.018)+(2.025), (I-749)+(1.018)+(2.026), (I-749)+(1.018)+(2.027), (I-749)+(1.018)+(2.028), (I-749)+(1.018)+(2.029), (I-749)+(1.018)+(2.030), (I-749)+(1.018)+(2.031), (I-749)+(1.018)+(2.032), (I-749)+(1.018)+(2.033), (I-749)+(1.018)+(2.034), (I-749)+(1.018)+(2.035), (I-749)+(1.018)+(2.036), (I-749)+(1.018)+(2.037), (I-749)+(1.018)+(2.038), (I-749)+(1.018)+(2.039), (I-749)+(1.018)+(2.040), (I-749)+(1.018)+(2.041), (I-749)+(1.018)+(2.042), (I-749)+(1.018)+(2.043), (I-749)+(1.018)+(2.044), (I-749)+(1.018)+(2.045), (I-749)+(1.018)+(2.046), (I-749)+(1.018)+(2.047), (I-749)+(1.018)+(2.048), (I-749)+(1.018)+(2.049), (I-749)+(1.018)+(2.050), (I-749)+(1.018)+(2.051), (I-749)+(1.018)+(2.052), (I-749)+(1.018)+(2.053), (I-749)+(1.018)+(2.054), (I-749)+(1.018)+(2.055), (I-749)+(1.018)+(2.056), (I-749)+(1.018)+(2.057), (I-749)+(1.018)+(2.058), (I-749)+(1.018)+(2.059), (I-749)+(1.018)+(3.001), (I-749)+(1.018)+(3.002), (I-749)+(1.018)+(3.003), (I-749)+(1.018)+(3.004), (I-749)+(1.018)+(3.005), (I-749)+(1.018)+(3.006), (I-749)+(1.018)+(3.007), (I-749)+(1.018)+(3.008), (I-749)+(1.018)+(3.009), (I-749)+(1.018)+(3.010), (I-749)+(1.018)+(3.011), (I-749)+(1.018)+(3.012), (I-749)+(1.018)+(3.013), (I-749)+(1.018)+(3.014), (I-749)+(1.018)+(3.015), (I-749)+(1.018)+(3.016), (I-749)+(1.018)+(3.017), (I-749)+(1.018)+(3.018), (I-749)+(1.018)+(3.019), (I-749)+(1.018)+(3.020), (I-749)+(1.018)+(3.021), (I-749)+(1.018)+(3.022), (I-749)+(1.018)+(3.023), (I-749)+(1.018)+(3.024), (I-749)+(1.018)+(3.025), (I-749)+(1.018)+(3.026), (I-749)+(1.018)+(3.027), (I-749)+(1.018)+(3.028), (I-749)+(1.018)+(3.029), (I-749)+(1.018)+(3.030), (I-749)+(1.018)+(3.031), (I-749)+(1.018)+(5.001), (I-749)+(1.018)+(5.002), (I-749)+(1.018)+(5.003), (I-749)+(1.018)+(5.004), (I-749)+(1.018)+(5.005), (I-749)+(1.018)+(5.006), (I-749)+(1.018)+(5.007), (I-749)+(1.018)+(5.008), (I-749)+(1.018)+(5.009), (I-749)+(1.018)+(5.010), (I-749)+(1.018)+(5.011), (I-749)+(1.018)+(5.012), (I-749)+(1.018)+(5.013), (I-749)+(1.018)+(5.014), (I-749)+(1.018)+(5.015), (I-749)+(1.018)+(5.016), (I-749)+(1.018)+(5.017), (I-749)+(1.018)+(5.018), (I-749)+(1.018)+(5.019), (I-749)+(1.018)+(5.020), (I-749)+(1.018)+(5.021), (I-749)+(1.018)+(5.022), (I-749)+(1.018)+(5.023), (I-749)+(1.018)+(6.001), (I-749)+(1.018)+(6.002), (I-749)+(1.018)+(6.003), (I-749)+(1.018)+(6.004), (I-749)+(1.018)+(7.001), (I-749)+(1.018)+(7.002), (I-749)+(1.018)+(7.003), (I-749)+(1.018)+(7.004), (I-749)+(1.018)+(7.005), (I-749)+(1.018)+(7.006), (I-749)+(1.018)+(9.001), (I-749)+(1.018)+(9.002), (I-749)+(1.018)+(9.003), (I-749)+(1.018)+(9.004), (I-749)+(1.018)+(9.005), (I-749)+(1.018)+(9.006), (I-749)+(1.018)+(9.007), (I-749)+(1.018)+(9.008), (I-749)+(1.018)+(9.009), (I-749)+(1.018)+(14.001), (I-749)+(1.018)+(14.002), (I-749)+(1.018)+(15.008), (I-749)+(1.018)+(15.011), (I-749)+(1.018)+(15.012), (I-749)+(1.018)+(15.016), (I-749)+(1.018)+(15.025), (I-749)+(1.018)+(15.027), (I-749)+(1.018)+(15.047), (I-749)+(1.018)+(15.063), (I-749)+(1.018)+(15.064), (I-749)+(1.018)+(16.001), (I-749)+(1.018)+(16.002), (I-749)+(1.018)+(16.003), (I-749)+(1.018)+(16.004), (I-749)+(1.018)+(16.005), (I-749)+(1.018)+(16.006), (I-749)+(1.018)+(16.007), (I-749)+(1.018)+(16.008), (I-749)+(1.018)+(17.001), (I-749)+(1.018)+(17.002), (I-749)+(1.018)+(17.003), (I-749)+(1.018)+(17.004), (I-749)+(1.018)+(17.005), (I-749)+(1.018)+(17.006), (I-749)+(1.018)+(17.007), (I-749)+(1.018)+(17.008), (I-749)+(1.018)+(17.009), (I-749)+(1.018)+(17.010), (I-749)+(1.018)+(17.011), (I-749)+(1.018)+(17.012), (I-749)+(1.018)+(18.001),

(I-749)+(1.019)+(1.020), (I-749)+(1.019)+(1.021), (I-749)+(1.019)+(1.022), (I-749)+(1.019)+(1.023), (I-749)+(1.019)+(1.024), (I-749)+(1.019)+(1.025), (I-749)+(1.019)+(1.026), (I-749)+(1.019)+(1.027), (I-749)+(1.019)+(1.028), (I-749)+(1.019)+(1.029), (I-749)+(1.019)+(1.030), (I-749)+(1.019)+(1.031), (I-749)+(1.019)+(1.032), (I-749)+(1.019)+(1.033), (I-749)+(1.019)+(1.034), (I-749)+(1.019)+(1.035), (I-749)+(1.019)+(1.036), (I-749)+(1.019)+(1.037), (I-749)+(1.019)+(1.038), (I-749)+(1.019)+(1.039), (I-749)+(1.019)+(1.040), (I-749)+(1.019)+(1.041), (I-749)+(1.019)+(1.042), (I-749)+(1.019)+(1.043), (I-749)+(1.019)+(1.044), (I-749)+(1.019)+(1.045), (I-749)+(1.019)+(1.046), (I-749)+(1.019)+(1.047), (I-749)+(1.019)+(1.048), (I-749)+(1.019)+(1.049), (I-749)+(1.019)+(1.050), (I-749)+(1.019)+(1.051), (I-749)+(1.019)+(1.052), (I-749)+(1.019)+(1.053), (I-749)+(1.019)+(1.054), (I-749)+(1.019)+(1.055), (I-749)+(1.019)+(1.056), (I-749)+(1.019)+(1.057), (I-749)+(1.019)+(1.058), (I-749)+(1.019)+(1.059), (I-749)+(1.019)+(1.060), (I-749)+(1.019)+(1.061), (I-749)+(1.019)+(1.062), (I-749)+(1.019)+(1.063), (I-749)+(1.019)+(1.064), (I-749)+(1.019)+(1.065), (I-749)+(1.019)+(1.066), (I-749)+(1.019)+(1.067), (I-749)+(1.019)+(1.068), (I-749)+(1.019)+(1.069), (I-749)+(1.019)+(1.070), (I-749)+(1.019)+(1.071), (I-749)+(1.019)+(1.072), (I-749)+(1.019)+(1.073), (I-749)+(1.019)+(1.074), (I-749)+(1.019)+(1.075), (I-749)+(1.019)+(1.076), (I-749)+(1.019)+(1.077), (I-749)+(1.019)+(1.078), (I-749)+(1.019)+(1.079), (I-749)+(1.019)+(1.080), (I-749)+(1.019)+(1.081), (I-749)+(1.019)+(1.082), (I-749)+(1.019)+(1.083), (I-749)+(1.019)+(1.084), (I-749)+(1.019)+(1.085), (I-749)+(1.019)+(1.086), (I-749)+(1.019)+(1.087), (I-749)+(1.019)+(1.088), (I-749)+(1.019)+(1.089), (I-749)+(1.019)+(1.090), (I-749)+(1.019)+(1.091), (I-749)+(1.019)+(1.092), (I-749)+(1.019)+(2.001), (I-749)+(1.019)+(2.002), (I-749)+(1.019)+(2.003), (I-749)+(1.019)+(2.004), (I-749)+(1.019)+(2.005), (I-749)+(1.019)+(2.006), (I-749)+(1.019)+(2.007), (I-749)+(1.019)+(2.008), (I-749)+(1.019)+(2.009), (I-749)+(1.019)+(2.010), (I-749)+(1.019)+(2.011), (I-749)+(1.019)+(2.012), (I-749)+(1.019)+(2.013), (I-749)+(1.019)+(2.014), (I-749)+(1.019)+(2.015), (I-749)+(1.019)+(2.016), (I-749)+(1.019)+(2.017), (I-749)+(1.019)+(2.018), (I-749)+(1.019)+(2.019), (I-749)+(1.019)+(2.020), (I-749)+(1.019)+(2.021), (I-749)+(1.019)+(2.022), (I-749)+(1.019)+(2.023), (I-749)+(1.019)+(2.024), (I-749)+(1.019)+(2.025), (I-749)+(1.019)+(2.026), (I-749)+(1.019)+(2.027), (I-749)+(1.019)+(2.028), (I-749)+(1.019)+(2.029), (I-749)+(1.019)+(2.030), (I-749)+(1.019)+(2.031), (I-749)+(1.019)+(2.032), (I-749)+(1.019)+(2.033), (I-749)+(1.019)+(2.034), (I-749)+(1.019)+(2.035), (I-749)+(1.019)+(2.036), (I-749)+(1.019)+(2.037), (I-749)+(1.019)+(2.038), (I-749)+(1.019)+(2.039), (I-749)+(1.019)+(2.040), (I-749)+(1.019)+(2.041), (I-749)+(1.019)+(2.042), (I-749)+(1.019)+(2.043), (I-749)+(1.019)+(2.044), (I-749)+(1.019)+(2.045), (I-749)+(1.019)+(2.046), (I-749)+(1.019)+(2.047), (I-749)+(1.019)+(2.048), (I-749)+(1.019)+(2.049), (I-749)+(1.019)+(2.050), (I-749)+(1.019)+(2.051), (I-749)+(1.019)+(2.052), (I-749)+(1.019)+(2.053), (I-749)+(1.019)+(2.054), (I-749)+(1.019)+(2.055), (I-749)+(1.019)+(2.056), (I-749)+(1.019)+(2.057), (I-749)+(1.019)+(2.058), (I-749)+(1.019)+(2.059), (I-749)+(1.019)+(3.001), (I-749)+(1.019)+(3.002), (I-749)+(1.019)+(3.003), (I-749)+(1.019)+(3.004), (I-749)+(1.019)+(3.005), (I-749)+(1.019)+(3.006), (I-749)+(1.019)+(3.007), (I-749)+(1.019)+(3.008), (I-749)+(1.019)+(3.009), (I-749)+(1.019)+(3.010), (I-749)+(1.019)+(3.011), (I-749)+(1.019)+(3.012), (I-749)+(1.019)+(3.013), (I-749)+(1.019)+(3.014), (I-749)+(1.019)+(3.015), (I-749)+(1.019)+(3.016), (I-749)+(1.019)+(3.017), (I-749)+(1.019)+(3.018), (I-749)+(1.019)+(3.019), (I-749)+(1.019)+(3.020), (I-749)+(1.019)+(3.021), (I-749)+(1.019)+(3.022), (I-749)+(1.019)+(3.023), (I-749)+(1.019)+(3.024), (I-749)+(1.019)+(3.025), (I-749)+(1.019)+(3.026), (I-749)+(1.019)+(3.027), (I-749)+(1.019)+(3.028), (I-749)+(1.019)+(3.029), (I-749)+(1.019)+(3.030), (I-749)+(1.019)+(3.031), (I-749)+(1.019)+(5.001), (I-749)+(1.019)+(5.002), (I-749)+(1.019)+(5.003), (I-749)+(1.019)+(5.004), (I-749)+(1.019)+(5.005), (I-749)+(1.019)+(5.006), (I-749)+(1.019)+(5.007), (I-749)+(1.019)+(5.008), (I-749)+(1.019)+(5.009), (I-749)+(1.019)+(5.010), (I-749)+(1.019)+(5.011), (I-749)+(1.019)+(5.012), (I-749)+(1.019)+(5.013), (I-749)+(1.019)+(5.014), (I-749)+(1.019)+(5.015), (I-749)+(1.019)+(5.016), (I-749)+(1.019)+(5.017), (I-749)+(1.019)+(5.018), (I-749)+(1.019)+(5.019), (I-749)+(1.019)+(5.020), (I-749)+(1.019)+(5.021), (I-749)+(1.019)+(5.022), (I-749)+(1.019)+(5.023), (I-749)+(1.019)+(6.001), (I-749)+(1.019)+(6.002), (I-749)+(1.019)+(6.003), (I-749)+(1.019)+(6.004), (I-749)+(1.019)+(7.001), (I-749)+(1.019)+(7.002), (I-749)+(1.019)+(7.003), (I-749)+(1.019)+(7.004), (I-749)+(1.019)+(7.005), (I-749)+(1.019)+(7.006), (I-749)+(1.019)+(9.001), (I-749)+(1.019)+(9.002), (I-749)+(1.019)+(9.003), (I-749)+(1.019)+(9.004), (I-749)+(1.019)+(9.005), (I-749)+(1.019)+(9.006), (I-749)+(1.019)+(9.007), (I-749)+(1.019)+(9.008), (I-749)+(1.019)+(9.009), (I-749)+(1.019)+(14.001), (I-749)+(1.019)+(14.002), (I-749)+(1.019)+(15.008), (I-749)+(1.019)+(15.011), (I-749)+(1.019)+(15.012), (I-749)+(1.019)+(15.016), (I-749)+(1.019)+(15.025), (I-749)+(1.019)+(15.027), (I-749)+(1.019)+(15.047), (I-749)+(1.019)+(15.063), (I-749)+(1.019)+(15.064), (I-749)+(1.019)+(16.001), (I-749)+(1.019)+(16.002), (I-749)+(1.019)+(16.003), (I-749)+(1.019)+(16.004), (I-749)+(1.019)+(16.005), (I-749)+(1.019)+(16.006), (I-749)+(1.019)+(16.007), (I-749)+(1.019)+(16.008), (I-749)+(1.019)+(17.001), (I-749)+(1.019)+(17.002), (I-749)+(1.019)+(17.003), (I-749)+(1.019)+(17.004), (I-749)+(1.019)+(17.005), (I-749)+(1.019)+(17.006), (I-749)+(1.019)+(17.007), (I-749)+(1.019)+(17.008), (I-749)+(1.019)+(17.009), (I-749)+(1.019)+(17.010), (I-749)+(1.019)+(17.011), (I-749)+(1.019)+(17.012), (I-749)+(1.019)+(18.001),

(I-749)+(1.020)+(1.021), (I-749)+(1.020)+(1.022), (I-749)+(1.020)+(1.023), (I-749)+(1.020)+(1.024), (I-749)+(1.020)+(1.025), (I-749)+(1.020)+(1.026), (I-749)+(1.020)+(1.027), (I-749)+(1.020)+(1.028), (I-749)+(1.020)+(1.029), (I-749)+(1.020)+(1.030), (I-749)+(1.020)+(1.031), (I-749)+(1.020)+(1.032), (I-749)+(1.020)+(1.033), (I-749)+(1.020)+(1.034), (I-749)+(1.020)+(1.035), (I-749)+(1.020)+(1.036), (I-749)+(1.020)+(1.037), (I-749)+(1.020)+(1.038), (I-749)+(1.020)+(1.039), (I-749)+(1.020)+(1.040), (I-749)+(1.020)+(1.041), (I-749)+(1.020)+(1.042), (I-749)+(1.020)+(1.043), (I-749)+(1.020)+(1.044), (I-749)+(1.020)+(1.045), (I-749)+(1.020)+(1.046), (I-749)+(1.020)+(1.047), (I-749)+(1.020)+(1.048), (I-749)+(1.020)+(1.049), (I-749)+(1.020)+(1.050), (I-749)+(1.020)+(1.051), (I-749)+(1.020)+(1.052), (I-749)+(1.020)+(1.053), (I-749)+(1.020)+(1.054), (I-749)+(1.020)+(1.055), (I-749)+(1.020)+(1.056), (I-749)+(1.020)+(1.057), (I-749)+(1.020)+(1.058), (I-749)+(1.020)+(1.059), (I-749)+(1.020)+(1.060), (I-749)+(1.020)+(1.061), (I-749)+(1.020)+(1.062), (I-749)+(1.020)+(1.063), (I-749)+(1.020)+(1.064), (I-749)+(1.020)+(1.065), (I-749)+(1.020)+(1.066), (I-749)+(1.020)+(1.067), (I-749)+(1.020)+(1.068), (I-749)+(1.020)+(1.069), (I-749)+(1.020)+(1.070), (I-749)+(1.020)+(1.071), (I-749)+(1.020)+(1.072), (I-749)+(1.020)+(1.073), (I-749)+(1.020)+(1.074), (I-749)+(1.020)+(1.075), (I-749)+(1.020)+(1.076), (I-749)+(1.020)+(1.077), (I-749)+(1.020)+(1.078), (I-749)+(1.020)+(1.079), (I-749)+(1.020)+(1.080), (I-749)+(1.020)+(1.081), (I-749)+(1.020)+(1.082), (I-749)+(1.020)+(1.083), (I-749)+(1.020)+(1.084), (I-749)+(1.020)+(1.085), (I-749)+(1.020)+(1.086), (I-749)+(1.020)+(1.087), (I-749)+(1.020)+(1.088), (I-749)+(1.020)+(1.089), (I-749)+(1.020)+(1.090), (I-749)+(1.020)+(1.091), (I-749)+(1.020)+(1.092), (I-749)+(1.020)+(2.001), (I-749)+(1.020)+(2.002), (I-749)+(1.020)+(2.003), (I-749)+(1.020)+(2.004), (I-749)+(1.020)+(2.005), (I-749)+(1.020)+(2.006), (I-749)+(1.020)+(2.007), (I-749)+(1.020)+(2.008), (I-749)+(1.020)+(2.009), (I-749)+(1.020)+(2.010), (I-749)+(1.020)+(2.011), (I-749)+(1.020)+(2.012), (I-749)+(1.020)+(2.013), (I-749)+(1.020)+(2.014), (I-749)+(1.020)+(2.015), (I-749)+(1.020)+(2.016), (I-749)+(1.020)+(2.017), (I-749)+(1.020)+(2.018), (I-749)+(1.020)+(2.019), (I-749)+(1.020)+(2.020), (I-749)+(1.020)+(2.021), (I-749)+(1.020)+(2.022), (I-749)+(1.020)+(2.023), (I-749)+(1.020)+(2.024), (I-749)+(1.020)+(2.025), (I-749)+(1.020)+(2.026), (I-749)+(1.020)+(2.027), (I-749)+(1.020)+(2.028), (I-749)+(1.020)+(2.029), (I-749)+(1.020)+(2.030), (I-749)+(1.020)+(2.031), (I-749)+(1.020)+(2.032), (I-749)+(1.020)+(2.033), (I-749)+(1.020)+(2.034), (I-749)+(1.020)+(2.035), (I-749)+(1.020)+(2.036), (I-749)+(1.020)+(2.037), (I-749)+(1.020)+(2.038), (I-749)+(1.020)+(2.039), (I-749)+(1.020)+(2.040), (I-749)+(1.020)+(2.041), (I-749)+(1.020)+(2.042), (I-749)+(1.020)+(2.043), (I-749)+(1.020)+(2.044), (I-749)+(1.020)+(2.045), (I-749)+(1.020)+(2.046), (I-749)+(1.020)+(2.047), (I-749)+(1.020)+(2.048), (I-749)+(1.020)+(2.049), (I-749)+(1.020)+(2.050), (I-749)+(1.020)+(2.051), (I-749)+(1.020)+(2.052), (I-749)+(1.020)+(2.053), (I-749)+(1.020)+(2.054), (I-749)+(1.020)+(2.055), (I-749)+(1.020)+(2.056), (I-749)+(1.020)+(2.057), (I-749)+(1.020)+(2.058), (I-749)+(1.020)+(2.059), (I-749)+(1.020)+(3.001), (I-749)+(1.020)+(3.002), (I-749)+(1.020)+(3.003), (I-749)+(1.020)+(3.004), (I-749)+(1.020)+(3.005), (I-749)+(1.020)+(3.006), (I-749)+(1.020)+(3.007), (I-749)+(1.020)+(3.008), (I-749)+(1.020)+(3.009), (I-749)+(1.020)+(3.010), (I-749)+(1.020)+(3.011), (I-749)+(1.020)+(3.012), (I-749)+(1.020)+(3.013), (I-749)+(1.020)+(3.014), (I-749)+(1.020)+(3.015), (I-749)+(1.020)+(3.016), (I-749)+(1.020)+(3.017), (I-749)+(1.020)+(3.018), (I-749)+(1.020)+(3.019), (I-749)+(1.020)+(3.020), (I-749)+(1.020)+(3.021), (I-749)+(1.020)+(3.022), (I-749)+(1.020)+(3.023), (I-749)+(1.020)+(3.024), (I-749)+(1.020)+(3.025), (I-749)+(1.020)+(3.026), (I-749)+(1.020)+(3.027), (I-749)+(1.020)+(3.028), (I-749)+(1.020)+(3.029), (I-749)+(1.020)+(3.030), (I-749)+(1.020)+(3.031), (I-749)+(1.020)+(5.001), (I-749)+(1.020)+(5.002), (I-749)+(1.020)+(5.003), (I-749)+(1.020)+(5.004), (I-749)+(1.020)+(5.005), (I-749)+(1.020)+(5.006), (I-749)+(1.020)+(5.007), (I-749)+(1.020)+(5.008), (I-749)+(1.020)+(5.009), (I-749)+(1.020)+(5.010), (I-749)+(1.020)+(5.011), (I-749)+(1.020)+(5.012), (I-749)+(1.020)+(5.013), (I-749)+(1.020)+(5.014), (I-749)+(1.020)+(5.015), (I-749)+(1.020)+(5.016), (I-749)+(1.020)+(5.017), (I-749)+(1.020)+(5.018), (I-749)+(1.020)+(5.019), (I-749)+(1.020)+(5.020), (I-749)+(1.020)+(5.021), (I-749)+(1.020)+(5.022), (I-749)+(1.020)+(5.023), (I-749)+(1.020)+(6.001), (I-749)+(1.020)+(6.002), (I-749)+(1.020)+(6.003), (I-749)+(1.020)+(6.004), (I-749)+(1.020)+(7.001), (I-749)+(1.020)+(7.002), (I-749)+(1.020)+(7.003), (I-749)+(1.020)+(7.004), (I-749)+(1.020)+(7.005), (I-749)+(1.020)+(7.006), (I-749)+(1.020)+(9.001), (I-749)+(1.020)+(9.002), (I-749)+(1.020)+(9.003), (I-749)+(1.020)+(9.004), (I-749)+(1.020)+(9.005), (I-749)+(1.020)+(9.006), (I-749)+(1.020)+(9.007), (I-749)+(1.020)+(9.008), (I-749)+(1.020)+(9.009), (I-749)+(1.020)+(14.001), (I-749)+(1.020)+(14.002), (I-749)+(1.020)+(15.008), (I-749)+(1.020)+(15.011), (I-749)+(1.020)+(15.012), (I-749)+(1.020)+(15.016), (I-749)+(1.020)+(15.025), (I-749)+(1.020)+(15.027), (I-749)+(1.020)+(15.047), (I-749)+(1.020)+(15.063), (I-749)+(1.020)+(15.064), (I-749)+(1.020)+(16.001), (I-749)+(1.020)+(16.002), (I-749)+(1.020)+(16.003), (I-749)+(1.020)+(16.004), (I-749)+(1.020)+(16.005), (I-749)+(1.020)+(16.006), (I-749)+(1.020)+(16.007), (I-749)+(1.020)+(16.008), (I-749)+(1.020)+(17.001), (I-749)+(1.020)+(17.002), (I-749)+(1.020)+(17.003), (I-749)+(1.020)+(17.004), (I-749)+(1.020)+(17.005), (I-749)+(1.020)+(17.006), (I-749)+(1.020)+(17.007), (I-749)+(1.020)+(17.008), (I-749)+(1.020)+(17.009), (I-749)+(1.020)+(17.010), (I-749)+(1.020)+(17.011), (I-749)+(1.020)+(17.012), (I-749)+(1.020)+(18.001),

(I-749)+(1.021)+(1.022), (I-749)+(1.021)+(1.023), (I-749)+(1.021)+(1.024), (I-749)+(1.021)+(1.025), (I-749)+(1.021)+(1.026), (I-749)+(1.021)+(1.027), (I-749)+(1.021)+(1.028), (I-749)+(1.021)+(1.029), (I-749)+(1.021)+(1.030), (I-749)+(1.021)+(1.031), (I-749)+(1.021)+(1.032), (I-749)+(1.021)+(1.033), (I-749)+(1.021)+(1.034), (I-749)+(1.021)+(1.035), (I-749)+(1.021)+(1.036), (I-749)+(1.021)+(1.037), (I-749)+(1.021)+(1.038), (I-749)+(1.021)+(1.039), (I-749)+(1.021)+(1.040), (I-749)+(1.021)+(1.041), (I-749)+(1.021)+(1.042), (I-749)+(1.021)+(1.043), (I-749)+(1.021)+(1.044), (I-749)+(1.021)+(1.045), (I-749)+(1.021)+(1.046), (I-749)+(1.021)+(1.047), (I-749)+(1.021)+(1.048), (I-749)+(1.021)+(1.049), (I-749)+(1.021)+(1.050), (I-749)+(1.021)+(1.051), (I-749)+(1.021)+(1.052), (I-749)+(1.021)+(1.053), (I-749)+(1.021)+(1.054), (I-749)+(1.021)+(1.055), (I-749)+(1.021)+(1.056), (I-749)+(1.021)+(1.057), (I-749)+(1.021)+(1.058), (I-749)+(1.021)+(1.059), (I-749)+(1.021)+(1.060), (I-749)+(1.021)+(1.061), (I-749)+(1.021)+(1.062), (I-749)+(1.021)+(1.063), (I-749)+(1.021)+(1.064), (I-749)+(1.021)+(1.065), (I-749)+(1.021)+(1.066), (I-749)+(1.021)+(1.067), (I-749)+(1.021)+(1.068), (I-749)+(1.021)+(1.069), (I-749)+(1.021)+(1.070), (I-749)+(1.021)+(1.071), (I-749)+(1.021)+(1.072), (I-749)+(1.021)+(1.073), (I-749)+(1.021)+(1.074), (I-749)+(1.021)+(1.075), (I-749)+(1.021)+(1.076), (I-749)+(1.021)+(1.077), (I-749)+(1.021)+(1.078), (I-749)+(1.021)+(1.079), (I-749)+(1.021)+(1.080), (I-749)+(1.021)+(1.081), (I-749)+(1.021)+(1.082), (I-749)+(1.021)+(1.083), (I-749)+(1.021)+(1.084), (I-749)+(1.021)+(1.085), (I-749)+(1.021)+(1.086), (I-749)+(1.021)+(1.087), (I-749)+(1.021)+(1.088), (I-749)+(1.021)+(1.089), (I-749)+(1.021)+(1.090), (I-749)+(1.021)+(1.091), (I-749)+(1.021)+(1.092), (I-749)+(1.021)+(2.001), (I-749)+(1.021)+(2.002), (I-749)+(1.021)+(2.003), (I-749)+(1.021)+(2.004), (I-749)+(1.021)+(2.005), (I-749)+(1.021)+(2.006), (I-749)+(1.021)+(2.007), (I-749)+(1.021)+(2.008), (I-749)+(1.021)+(2.009), (I-749)+(1.021)+(2.010), (I-749)+(1.021)+(2.011), (I-749)+(1.021)+(2.012), (I-749)+(1.021)+(2.013), (I-749)+(1.021)+(2.014), (I-749)+(1.021)+(2.015), (I-749)+(1.021)+(2.016), (I-749)+(1.021)+(2.017), (I-749)+(1.021)+(2.018), (I-749)+(1.021)+(2.019), (I-749)+(1.021)+(2.020), (I-749)+(1.021)+(2.021), (I-749)+(1.021)+(2.022), (I-749)+(1.021)+(2.023), (I-749)+(1.021)+(2.024), (I-749)+(1.021)+(2.025), (I-749)+(1.021)+(2.026), (I-749)+(1.021)+(2.027), (I-749)+(1.021)+(2.028), (I-749)+(1.021)+(2.029), (I-749)+(1.021)+(2.030), (I-749)+(1.021)+(2.031), (I-749)+(1.021)+(2.032), (I-749)+(1.021)+(2.033), (I-749)+(1.021)+(2.034), (I-749)+(1.021)+(2.035), (I-749)+(1.021)+(2.036), (I-749)+(1.021)+(2.037), (I-749)+(1.021)+(2.038), (I-749)+(1.021)+(2.039), (I-749)+(1.021)+(2.040), (I-749)+(1.021)+(2.041), (I-749)+(1.021)+(2.042), (I-749)+(1.021)+(2.043), (I-749)+(1.021)+(2.044), (I-749)+(1.021)+(2.045), (I-749)+(1.021)+(2.046), (I-749)+(1.021)+(2.047), (I-749)+(1.021)+(2.048), (I-749)+(1.021)+(2.049), (I-749)+(1.021)+(2.050), (I-749)+(1.021)+(2.051), (I-749)+(1.021)+(2.052), (I-749)+(1.021)+(2.053), (I-749)+(1.021)+(2.054), (I-749)+(1.021)+(2.055), (I-749)+(1.021)+(2.056), (I-749)+(1.021)+(2.057), (I-749)+(1.021)+(2.058), (I-749)+(1.021)+(2.059), (I-749)+(1.021)+(3.001), (I-749)+(1.021)+(3.002), (I-749)+(1.021)+(3.003), (I-749)+(1.021)+(3.004), (I-749)+(1.021)+(3.005), (I-749)+(1.021)+(3.006), (I-749)+(1.021)+(3.007), (I-749)+(1.021)+(3.008), (I-749)+(1.021)+(3.009), (I-749)+(1.021)+(3.010), (I-749)+(1.021)+(3.011), (I-749)+(1.021)+(3.012), (I-749)+(1.021)+(3.013), (I-749)+(1.021)+(3.014), (I-749)+(1.021)+(3.015), (I-749)+(1.021)+(3.016), (I-749)+(1.021)+(3.017), (I-749)+(1.021)+(3.018), (I-749)+(1.021)+(3.019), (I-749)+(1.021)+(3.020), (I-749)+(1.021)+(3.021), (I-749)+(1.021)+(3.022), (I-749)+(1.021)+(3.023), (I-749)+(1.021)+(3.024), (I-749)+(1.021)+(3.025), (I-749)+(1.021)+(3.026), (I-749)+(1.021)+(3.027), (I-749)+(1.021)+(3.028), (I-749)+(1.021)+(3.029), (I-749)+(1.021)+(3.030), (I-749)+(1.021)+(3.031), (I-749)+(1.021)+(5.001), (I-749)+(1.021)+(5.002), (I-749)+(1.021)+(5.003), (I-749)+(1.021)+(5.004), (I-749)+(1.021)+(5.005), (I-749)+(1.021)+(5.006), (I-749)+(1.021)+(5.007), (I-749)+(1.021)+(5.008), (I-749)+(1.021)+(5.009), (I-749)+(1.021)+(5.010), (I-749)+(1.021)+(5.011), (I-749)+(1.021)+(5.012), (I-749)+(1.021)+(5.013), (I-749)+(1.021)+(5.014), (I-749)+(1.021)+(5.015), (I-749)+(1.021)+(5.016), (I-749)+(1.021)+(5.017), (I-749)+(1.021)+(5.018), (I-749)+(1.021)+(5.019), (I-749)+(1.021)+(5.020), (I-749)+(1.021)+(5.021), (I-749)+(1.021)+(5.022), (I-749)+(1.021)+(5.023), (I-749)+(1.021)+(6.001), (I-749)+(1.021)+(6.002), (I-749)+(1.021)+(6.003), (I-749)+(1.021)+(6.004), (I-749)+(1.021)+(7.001), (I-749)+(1.021)+(7.002), (I-749)+(1.021)+(7.003), (I-749)+(1.021)+(7.004), (I-749)+(1.021)+(7.005), (I-749)+(1.021)+(7.006), (I-749)+(1.021)+(9.001), (I-749)+(1.021)+(9.002), (I-749)+(1.021)+(9.003), (I-749)+(1.021)+(9.004), (I-749)+(1.021)+(9.005), (I-749)+(1.021)+(9.006), (I-749)+(1.021)+(9.007), (I-749)+(1.021)+(9.008), (I-749)+(1.021)+(9.009), (I-749)+(1.021)+(14.001), (I-749)+(1.021)+(14.002), (I-749)+(1.021)+(15.008), (I-749)+(1.021)+(15.011), (I-749)+(1.021)+(15.012), (I-749)+(1.021)+(15.016), (I-749)+(1.021)+(15.025), (I-749)+(1.021)+(15.027), (I-749)+(1.021)+(15.047), (I-749)+(1.021)+(15.063), (I-749)+(1.021)+(15.064), (I-749)+(1.021)+(16.001), (I-749)+(1.021)+(16.002), (I-749)+(1.021)+(16.003), (I-749)+(1.021)+(16.004), (I-749)+(1.021)+(16.005), (I-749)+(1.021)+(16.006), (I-749)+(1.021)+(16.007), (I-749)+(1.021)+(16.008), (I-749)+(1.021)+(17.001), (I-749)+(1.021)+(17.002), (I-749)+(1.021)+(17.003), (I-749)+(1.021)+(17.004), (I-749)+(1.021)+(17.005), (I-749)+(1.021)+(17.006), (I-749)+(1.021)+(17.007), (I-749)+(1.021)+(17.008), (I-749)+(1.021)+(17.009), (I-749)+(1.021)+(17.010), (I-749)+(1.021)+(17.011), (I-749)+(1.021)+(17.012), (I-749)+(1.021)+(18.001),

(I-749)+(1.022)+(1.023), (I-749)+(1.022)+(1.024), (I-749)+(1.022)+(1.025), (I-749)+(1.022)+(1.026), (I-749)+(1.022)+(1.027), (I-749)+(1.022)+(1.028), (I-749)+(1.022)+(1.029), (I-749)+(1.022)+(1.030), (I-749)+(1.022)+(1.031), (I-749)+(1.022)+(1.032), (I-749)+(1.022)+(1.033), (I-749)+(1.022)+(1.034), (I-749)+(1.022)+(1.035), (I-749)+(1.022)+(1.036), (I-749)+(1.022)+(1.037), (I-749)+(1.022)+(1.038), (I-749)+(1.022)+(1.039), (I-749)+(1.022)+(1.040), (I-749)+(1.022)+(1.041), (I-749)+(1.022)+(1.042), (I-749)+(1.022)+(1.043), (I-749)+(1.022)+(1.044), (I-749)+(1.022)+(1.045), (I-749)+(1.022)+(1.046), (I-749)+(1.022)+(1.047), (I-749)+(1.022)+(1.048), (I-749)+(1.022)+(1.049), (I-749)+(1.022)+(1.050), (I-749)+(1.022)+(1.051), (I-749)+(1.022)+(1.052), (I-749)+(1.022)+(1.053), (I-749)+(1.022)+(1.054), (I-749)+(1.022)+(1.055), (I-749)+(1.022)+(1.056), (I-749)+(1.022)+(1.057), (I-749)+(1.022)+(1.058), (I-749)+(1.022)+(1.059), (I-749)+(1.022)+(1.060), (I-749)+(1.022)+(1.061), (I-749)+(1.022)+(1.062), (I-749)+(1.022)+(1.063), (I-749)+(1.022)+(1.064), (I-749)+(1.022)+(1.065), (I-749)+(1.022)+(1.066), (I-749)+(1.022)+(1.067), (I-749)+(1.022)+(1.068), (I-749)+(1.022)+(1.069), (I-749)+(1.022)+(1.070), (I-749)+(1.022)+(1.071), (I-749)+(1.022)+(1.072), (I-749)+(1.022)+(1.073), (I-749)+(1.022)+(1.074), (I-749)+(1.022)+(1.075), (I-749)+(1.022)+(1.076), (I-749)+(1.022)+(1.077), (I-749)+(1.022)+(1.078), (I-749)+(1.022)+(1.079), (I-749)+(1.022)+(1.080), (I-749)+(1.022)+(1.081), (I-749)+(1.022)+(1.082), (I-749)+(1.022)+(1.083), (I-749)+(1.022)+(1.084), (I-749)+(1.022)+(1.085), (I-749)+(1.022)+(1.086), (I-749)+(1.022)+(1.087), (I-749)+(1.022)+(1.088), (I-749)+(1.022)+(1.089), (I-749)+(1.022)+(1.090), (I-749)+(1.022)+(1.091), (I-749)+(1.022)+(1.092), (I-749)+(1.022)+(2.001), (I-749)+(1.022)+(2.002), (I-749)+(1.022)+(2.003), (I-749)+(1.022)+(2.004), (I-749)+(1.022)+(2.005), (I-749)+(1.022)+(2.006), (I-749)+(1.022)+(2.007), (I-749)+(1.022)+(2.008), (I-749)+(1.022)+(2.009), (I-749)+(1.022)+(2.010), (I-749)+(1.022)+(2.011), (I-749)+(1.022)+(2.012), (I-749)+(1.022)+(2.013), (I-749)+(1.022)+(2.014), (I-749)+(1.022)+(2.015), (I-749)+(1.022)+(2.016), (I-749)+(1.022)+(2.017), (I-749)+(1.022)+(2.018), (I-749)+(1.022)+(2.019), (I-749)+(1.022)+(2.020), (I-749)+(1.022)+(2.021), (I-749)+(1.022)+(2.022), (I-749)+(1.022)+(2.023), (I-749)+(1.022)+(2.024), (I-749)+(1.022)+(2.025), (I-749)+(1.022)+(2.026), (I-749)+(1.022)+(2.027), (I-749)+(1.022)+(2.028), (I-749)+(1.022)+(2.029), (I-749)+(1.022)+(2.030), (I-749)+(1.022)+(2.031), (I-749)+(1.022)+(2.032), (I-749)+(1.022)+(2.033), (I-749)+(1.022)+(2.034), (I-749)+(1.022)+(2.035), (I-749)+(1.022)+(2.036), (I-749)+(1.022)+(2.037), (I-749)+(1.022)+(2.038), (I-749)+(1.022)+(2.039), (I-749)+(1.022)+(2.040), (I-749)+(1.022)+(2.041), (I-749)+(1.022)+(2.042), (I-749)+(1.022)+(2.043), (I-749)+(1.022)+(2.044), (I-749)+(1.022)+(2.045), (I-749)+(1.022)+(2.046), (I-749)+(1.022)+(2.047), (I-749)+(1.022)+(2.048), (I-749)+(1.022)+(2.049), (I-749)+(1.022)+(2.050), (I-749)+(1.022)+(2.051), (I-749)+(1.022)+(2.052), (I-749)+(1.022)+(2.053), (I-749)+(1.022)+(2.054), (I-749)+(1.022)+(2.055), (I-749)+(1.022)+(2.056), (I-749)+(1.022)+(2.057), (I-749)+(1.022)+(2.058), (I-749)+(1.022)+(2.059), (I-749)+(1.022)+(3.001), (I-749)+(1.022)+(3.002), (I-749)+(1.022)+(3.003), (I-749)+(1.022)+(3.004), (I-749)+(1.022)+(3.005), (I-749)+(1.022)+(3.006), (I-749)+(1.022)+(3.007), (I-749)+(1.022)+(3.008), (I-749)+(1.022)+(3.009), (I-749)+(1.022)+(3.010), (I-749)+(1.022)+(3.011), (I-749)+(1.022)+(3.012), (I-749)+(1.022)+(3.013), (I-749)+(1.022)+(3.014), (I-749)+(1.022)+(3.015), (I-749)+(1.022)+(3.016), (I-749)+(1.022)+(3.017), (I-749)+(1.022)+(3.018), (I-749)+(1.022)+(3.019), (I-749)+(1.022)+(3.020), (I-749)+(1.022)+(3.021), (I-749)+(1.022)+(3.022), (I-749)+(1.022)+(3.023), (I-749)+(1.022)+(3.024), (I-749)+(1.022)+(3.025), (I-749)+(1.022)+(3.026), (I-749)+(1.022)+(3.027), (I-749)+(1.022)+(3.028), (I-749)+(1.022)+(3.029), (I-749)+(1.022)+(3.030), (I-749)+(1.022)+(3.031), (I-749)+(1.022)+(5.001), (I-749)+(1.022)+(5.002), (I-749)+(1.022)+(5.003), (I-749)+(1.022)+(5.004), (I-749)+(1.022)+(5.005), (I-749)+(1.022)+(5.006), (I-749)+(1.022)+(5.007), (I-749)+(1.022)+(5.008), (I-749)+(1.022)+(5.009), (I-749)+(1.022)+(5.010), (I-749)+(1.022)+(5.011), (I-749)+(1.022)+(5.012), (I-749)+(1.022)+(5.013), (I-749)+(1.022)+(5.014), (I-749)+(1.022)+(5.015), (I-749)+(1.022)+(5.016), (I-749)+(1.022)+(5.017), (I-749)+(1.022)+(5.018), (I-749)+(1.022)+(5.019), (I-749)+(1.022)+(5.020), (I-749)+(1.022)+(5.021), (I-749)+(1.022)+(5.022), (I-749)+(1.022)+(5.023), (I-749)+(1.022)+(6.001), (I-749)+(1.022)+(6.002), (I-749)+(1.022)+(6.003), (I-749)+(1.022)+(6.004), (I-749)+(1.022)+(7.001), (I-749)+(1.022)+(7.002), (I-749)+(1.022)+(7.003), (I-749)+(1.022)+(7.004), (I-749)+(1.022)+(7.005), (I-749)+(1.022)+(7.006), (I-749)+(1.022)+(9.001), (I-749)+(1.022)+(9.002), (I-749)+(1.022)+(9.003), (I-749)+(1.022)+(9.004), (I-749)+(1.022)+(9.005), (I-749)+(1.022)+(9.006), (I-749)+(1.022)+(9.007), (I-749)+(1.022)+(9.008), (I-749)+(1.022)+(9.009), (I-749)+(1.022)+(14.001), (I-749)+(1.022)+(14.002), (I-749)+(1.022)+(15.008), (I-749)+(1.022)+(15.011), (I-749)+(1.022)+(15.012), (I-749)+(1.022)+(15.016), (I-749)+(1.022)+(15.025), (I-749)+(1.022)+(15.027), (I-749)+(1.022)+(15.047), (I-749)+(1.022)+(15.063), (I-749)+(1.022)+(15.064), (I-749)+(1.022)+(16.001), (I-749)+(1.022)+(16.002), (I-749)+(1.022)+(16.003), (I-749)+(1.022)+(16.004), (I-749)+(1.022)+(16.005), (I-749)+(1.022)+(16.006), (I-749)+(1.022)+(16.007), (I-749)+(1.022)+(16.008), (I-749)+(1.022)+(17.001), (I-749)+(1.022)+(17.002), (I-749)+(1.022)+(17.003), (I-749)+(1.022)+(17.004), (I-749)+(1.022)+(17.005), (I-749)+(1.022)+(17.006), (I-749)+(1.022)+(17.007), (I-749)+(1.022)+(17.008), (I-749)+(1.022)+(17.009), (I-749)+(1.022)+(17.010), (I-749)+(1.022)+(17.011), (I-749)+(1.022)+(17.012), (I-749)+(1.022)+(18.001),

(I-749)+(1.023)+(1.024), (I-749)+(1.023)+(1.025), (I-749)+(1.023)+(1.026), (I-749)+(1.023)+(1.027), (I-749)+(1.023)+(1.028), (I-749)+(1.023)+(1.029), (I-749)+(1.023)+(1.030), (I-749)+(1.023)+(1.031), (I-749)+(1.023)+(1.032), (I-749)+(1.023)+(1.033), (I-749)+(1.023)+(1.034), (I-749)+(1.023)+(1.035), (I-749)+(1.023)+(1.036), (I-749)+(1.023)+(1.037), (I-749)+(1.023)+(1.038), (I-749)+(1.023)+(1.039), (I-749)+(1.023)+(1.040), (I-749)+(1.023)+(1.041), (I-749)+(1.023)+(1.042), (I-749)+(1.023)+(1.043), (I-749)+(1.023)+(1.044), (I-749)+(1.023)+(1.045), (I-749)+(1.023)+(1.046), (I-749)+(1.023)+(1.047), (I-749)+(1.023)+(1.048), (I-749)+(1.023)+(1.049), (I-749)+(1.023)+(1.050), (I-749)+(1.023)+(1.051), (I-749)+(1.023)+(1.052), (I-749)+(1.023)+(1.053), (I-749)+(1.023)+(1.054), (I-749)+(1.023)+(1.055), (I-749)+(1.023)+(1.056), (I-749)+(1.023)+(1.057), (I-749)+(1.023)+(1.058), (I-749)+(1.023)+(1.059), (I-749)+(1.023)+(1.060), (I-749)+(1.023)+(1.061), (I-749)+(1.023)+(1.062), (I-749)+(1.023)+(1.063), (I-749)+(1.023)+(1.064), (I-749)+(1.023)+(1.065), (I-749)+(1.023)+(1.066), (I-749)+(1.023)+(1.067), (I-749)+(1.023)+(1.068), (I-749)+(1.023)+(1.069), (I-749)+(1.023)+(1.070), (I-749)+(1.023)+(1.071), (I-749)+(1.023)+(1.072), (I-749)+(1.023)+(1.073), (I-749)+(1.023)+(1.074), (I-749)+(1.023)+(1.075), (I-749)+(1.023)+(1.076), (I-749)+(1.023)+(1.077), (I-749)+(1.023)+(1.078), (I-749)+(1.023)+(1.079), (I-749)+(1.023)+(1.080), (I-749)+(1.023)+(1.081), (I-749)+(1.023)+(1.082), (I-749)+(1.023)+(1.083), (I-749)+(1.023)+(1.084), (I-749)+(1.023)+(1.085), (I-749)+(1.023)+(1.086), (I-749)+(1.023)+(1.087), (I-749)+(1.023)+(1.088), (I-749)+(1.023)+(1.089), (I-749)+(1.023)+(1.090), (I-749)+(1.023)+(1.091), (I-749)+(1.023)+(1.092), (I-749)+(1.023)+(2.001), (I-749)+(1.023)+(2.002), (I-749)+(1.023)+(2.003), (I-749)+(1.023)+(2.004), (I-749)+(1.023)+(2.005), (I-749)+(1.023)+(2.006), (I-749)+(1.023)+(2.007), (I-749)+(1.023)+(2.008), (I-749)+(1.023)+(2.009), (I-749)+(1.023)+(2.010), (I-749)+(1.023)+(2.011), (I-749)+(1.023)+(2.012), (I-749)+(1.023)+(2.013), (I-749)+(1.023)+(2.014), (I-749)+(1.023)+(2.015), (I-749)+(1.023)+(2.016), (I-749)+(1.023)+(2.017), (I-749)+(1.023)+(2.018), (I-749)+(1.023)+(2.019), (I-749)+(1.023)+(2.020), (I-749)+(1.023)+(2.021), (I-749)+(1.023)+(2.022), (I-749)+(1.023)+(2.023), (I-749)+(1.023)+(2.024), (I-749)+(1.023)+(2.025), (I-749)+(1.023)+(2.026), (I-749)+(1.023)+(2.027), (I-749)+(1.023)+(2.028), (I-749)+(1.023)+(2.029), (I-749)+(1.023)+(2.030), (I-749)+(1.023)+(2.031), (I-749)+(1.023)+(2.032), (I-749)+(1.023)+(2.033), (I-749)+(1.023)+(2.034), (I-749)+(1.023)+(2.035), (I-749)+(1.023)+(2.036), (I-749)+(1.023)+(2.037), (I-749)+(1.023)+(2.038), (I-749)+(1.023)+(2.039), (I-749)+(1.023)+(2.040), (I-749)+(1.023)+(2.041), (I-749)+(1.023)+(2.042), (I-749)+(1.023)+(2.043), (I-749)+(1.023)+(2.044), (I-749)+(1.023)+(2.045), (I-749)+(1.023)+(2.046), (I-749)+(1.023)+(2.047), (I-749)+(1.023)+(2.048), (I-749)+(1.023)+(2.049), (I-749)+(1.023)+(2.050), (I-749)+(1.023)+(2.051), (I-749)+(1.023)+(2.052), (I-749)+(1.023)+(2.053), (I-749)+(1.023)+(2.054), (I-749)+(1.023)+(2.055), (I-749)+(1.023)+(2.056), (I-749)+(1.023)+(2.057), (I-749)+(1.023)+(2.058), (I-749)+(1.023)+(2.059), (I-749)+(1.023)+(3.001), (I-749)+(1.023)+(3.002), (I-749)+(1.023)+(3.003), (I-749)+(1.023)+(3.004), (I-749)+(1.023)+(3.005), (I-749)+(1.023)+(3.006), (I-749)+(1.023)+(3.007), (I-749)+(1.023)+(3.008), (I-749)+(1.023)+(3.009), (I-749)+(1.023)+(3.010), (I-749)+(1.023)+(3.011), (I-749)+(1.023)+(3.012), (I-749)+(1.023)+(3.013), (I-749)+(1.023)+(3.014), (I-749)+(1.023)+(3.015), (I-749)+(1.023)+(3.016), (I-749)+(1.023)+(3.017), (I-749)+(1.023)+(3.018), (I-749)+(1.023)+(3.019), (I-749)+(1.023)+(3.020), (I-749)+(1.023)+(3.021), (I-749)+(1.023)+(3.022), (I-749)+(1.023)+(3.023), (I-749)+(1.023)+(3.024), (I-749)+(1.023)+(3.025), (I-749)+(1.023)+(3.026), (I-749)+(1.023)+(3.027), (I-749)+(1.023)+(3.028), (I-749)+(1.023)+(3.029), (I-749)+(1.023)+(3.030), (I-749)+(1.023)+(3.031), (I-749)+(1.023)+(5.001), (I-749)+(1.023)+(5.002), (I-749)+(1.023)+(5.003), (I-749)+(1.023)+(5.004), (I-749)+(1.023)+(5.005), (I-749)+(1.023)+(5.006), (I-749)+(1.023)+(5.007), (I-749)+(1.023)+(5.008), (I-749)+(1.023)+(5.009), (I-749)+(1.023)+(5.010), (I-749)+(1.023)+(5.011), (I-749)+(1.023)+(5.012), (I-749)+(1.023)+(5.013), (I-749)+(1.023)+(5.014), (I-749)+(1.023)+(5.015), (I-749)+(1.023)+(5.016), (I-749)+(1.023)+(5.017), (I-749)+(1.023)+(5.018), (I-749)+(1.023)+(5.019), (I-749)+(1.023)+(5.020), (I-749)+(1.023)+(5.021), (I-749)+(1.023)+(5.022), (I-749)+(1.023)+(5.023), (I-749)+(1.023)+(6.001), (I-749)+(1.023)+(6.002), (I-749)+(1.023)+(6.003), (I-749)+(1.023)+(6.004), (I-749)+(1.023)+(7.001), (I-749)+(1.023)+(7.002), (I-749)+(1.023)+(7.003), (I-749)+(1.023)+(7.004), (I-749)+(1.023)+(7.005), (I-749)+(1.023)+(7.006), (I-749)+(1.023)+(9.001), (I-749)+(1.023)+(9.002), (I-749)+(1.023)+(9.003), (I-749)+(1.023)+(9.004), (I-749)+(1.023)+(9.005), (I-749)+(1.023)+(9.006), (I-749)+(1.023)+(9.007), (I-749)+(1.023)+(9.008), (I-749)+(1.023)+(9.009), (I-749)+(1.023)+(14.001), (I-749)+(1.023)+(14.002), (I-749)+(1.023)+(15.008), (I-749)+(1.023)+(15.011), (I-749)+(1.023)+(15.012), (I-749)+(1.023)+(15.016), (I-749)+(1.023)+(15.025), (I-749)+(1.023)+(15.027), (I-749)+(1.023)+(15.047), (I-749)+(1.023)+(15.063), (I-749)+(1.023)+(15.064), (I-749)+(1.023)+(16.001), (I-749)+(1.023)+(16.002), (I-749)+(1.023)+(16.003), (I-749)+(1.023)+(16.004), (I-749)+(1.023)+(16.005), (I-749)+(1.023)+(16.006), (I-749)+(1.023)+(16.007), (I-749)+(1.023)+(16.008), (I-749)+(1.023)+(17.001), (I-749)+(1.023)+(17.002), (I-749)+(1.023)+(17.003), (I-749)+(1.023)+(17.004), (I-749)+(1.023)+(17.005), (I-749)+(1.023)+(17.006), (I-749)+(1.023)+(17.007), (I-749)+(1.023)+(17.008), (I-749)+(1.023)+(17.009), (I-749)+(1.023)+(17.010), (I-749)+(1.023)+(17.011), (I-749)+(1.023)+(17.012), (I-749)+(1.023)+(18.001),

(I-749)+(1.024)+(1.025), (I-749)+(1.024)+(1.026), (I-749)+(1.024)+(1.027), (I-749)+(1.024)+(1.028), (I-749)+(1.024)+(1.029), (I-749)+(1.024)+(1.030), (I-749)+(1.024)+(1.031), (I-749)+(1.024)+(1.032), (I-749)+(1.024)+(1.033), (I-749)+(1.024)+(1.034), (I-749)+(1.024)+(1.035), (I-749)+(1.024)+(1.036), (I-749)+(1.024)+(1.037), (I-749)+(1.024)+(1.038), (I-749)+(1.024)+(1.039), (I-749)+(1.024)+(1.040), (I-749)+(1.024)+(1.041), (I-749)+(1.024)+(1.042), (I-749)+(1.024)+(1.043), (I-749)+(1.024)+(1.044), (I-749)+(1.024)+(1.045), (I-749)+(1.024)+(1.046), (I-749)+(1.024)+(1.047), (I-749)+(1.024)+(1.048), (I-749)+(1.024)+(1.049), (I-749)+(1.024)+(1.050), (I-749)+(1.024)+(1.051), (I-749)+(1.024)+(1.052), (I-749)+(1.024)+(1.053), (I-749)+(1.024)+(1.054), (I-749)+(1.024)+(1.055), (I-749)+(1.024)+(1.056), (I-749)+(1.024)+(1.057), (I-749)+(1.024)+(1.058), (I-749)+(1.024)+(1.059), (I-749)+(1.024)+(1.060), (I-749)+(1.024)+(1.061), (I-749)+(1.024)+(1.062), (I-749)+(1.024)+(1.063), (I-749)+(1.024)+(1.064), (I-749)+(1.024)+(1.065), (I-749)+(1.024)+(1.066), (I-749)+(1.024)+(1.067), (I-749)+(1.024)+(1.068), (I-749)+(1.024)+(1.069), (I-749)+(1.024)+(1.070), (I-749)+(1.024)+(1.071), (I-749)+(1.024)+(1.072), (I-749)+(1.024)+(1.073), (I-749)+(1.024)+(1.074), (I-749)+(1.024)+(1.075), (I-749)+(1.024)+(1.076), (I-749)+(1.024)+(1.077), (I-749)+(1.024)+(1.078), (I-749)+(1.024)+(1.079), (I-749)+(1.024)+(1.080), (I-749)+(1.024)+(1.081), (I-749)+(1.024)+(1.082), (I-749)+(1.024)+(1.083), (I-749)+(1.024)+(1.084), (I-749)+(1.024)+(1.085), (I-749)+(1.024)+(1.086), (I-749)+(1.024)+(1.087), (I-749)+(1.024)+(1.088), (I-749)+(1.024)+(1.089), (I-749)+(1.024)+(1.090), (I-749)+(1.024)+(1.091), (I-749)+(1.024)+(1.092), (I-749)+(1.024)+(2.001), (I-749)+(1.024)+(2.002), (I-749)+(1.024)+(2.003), (I-749)+(1.024)+(2.004), (I-749)+(1.024)+(2.005), (I-749)+(1.024)+(2.006), (I-749)+(1.024)+(2.007), (I-749)+(1.024)+(2.008), (I-749)+(1.024)+(2.009), (I-749)+(1.024)+(2.010), (I-749)+(1.024)+(2.011), (I-749)+(1.024)+(2.012), (I-749)+(1.024)+(2.013), (I-749)+(1.024)+(2.014), (I-749)+(1.024)+(2.015), (I-749)+(1.024)+(2.016), (I-749)+(1.024)+(2.017), (I-749)+(1.024)+(2.018), (I-749)+(1.024)+(2.019), (I-749)+(1.024)+(2.020), (I-749)+(1.024)+(2.021), (I-749)+(1.024)+(2.022), (I-749)+(1.024)+(2.023), (I-749)+(1.024)+(2.024), (I-749)+(1.024)+(2.025), (I-749)+(1.024)+(2.026), (I-749)+(1.024)+(2.027), (I-749)+(1.024)+(2.028), (I-749)+(1.024)+(2.029), (I-749)+(1.024)+(2.030), (I-749)+(1.024)+(2.031), (I-749)+(1.024)+(2.032), (I-749)+(1.024)+(2.033), (I-749)+(1.024)+(2.034), (I-749)+(1.024)+(2.035), (I-749)+(1.024)+(2.036), (I-749)+(1.024)+(2.037), (I-749)+(1.024)+(2.038), (I-749)+(1.024)+(2.039), (I-749)+(1.024)+(2.040), (I-749)+(1.024)+(2.041), (I-749)+(1.024)+(2.042), (I-749)+(1.024)+(2.043), (I-749)+(1.024)+(2.044), (I-749)+(1.024)+(2.045), (I-749)+(1.024)+(2.046), (I-749)+(1.024)+(2.047), (I-749)+(1.024)+(2.048), (I-749)+(1.024)+(2.049), (I-749)+(1.024)+(2.050), (I-749)+(1.024)+(2.051), (I-749)+(1.024)+(2.052), (I-749)+(1.024)+(2.053), (I-749)+(1.024)+(2.054), (I-749)+(1.024)+(2.055), (I-749)+(1.024)+(2.056), (I-749)+(1.024)+(2.057), (I-749)+(1.024)+(2.058), (I-749)+(1.024)+(2.059), (I-749)+(1.024)+(3.001), (I-749)+(1.024)+(3.002), (I-749)+(1.024)+(3.003), (I-749)+(1.024)+(3.004), (I-749)+(1.024)+(3.005), (I-749)+(1.024)+(3.006), (I-749)+(1.024)+(3.007), (I-749)+(1.024)+(3.008), (I-749)+(1.024)+(3.009), (I-749)+(1.024)+(3.010), (I-749)+(1.024)+(3.011), (I-749)+(1.024)+(3.012), (I-749)+(1.024)+(3.013), (I-749)+(1.024)+(3.014), (I-749)+(1.024)+(3.015), (I-749)+(1.024)+(3.016), (I-749)+(1.024)+(3.017), (I-749)+(1.024)+(3.018), (I-749)+(1.024)+(3.019), (I-749)+(1.024)+(3.020), (I-749)+(1.024)+(3.021), (I-749)+(1.024)+(3.022), (I-749)+(1.024)+(3.023), (I-749)+(1.024)+(3.024), (I-749)+(1.024)+(3.025), (I-749)+(1.024)+(3.026), (I-749)+(1.024)+(3.027), (I-749)+(1.024)+(3.028), (I-749)+(1.024)+(3.029), (I-749)+(1.024)+(3.030), (I-749)+(1.024)+(3.031), (I-749)+(1.024)+(5.001), (I-749)+(1.024)+(5.002), (I-749)+(1.024)+(5.003), (I-749)+(1.024)+(5.004), (I-749)+(1.024)+(5.005), (I-749)+(1.024)+(5.006), (I-749)+(1.024)+(5.007), (I-749)+(1.024)+(5.008), (I-749)+(1.024)+(5.009), (I-749)+(1.024)+(5.010), (I-749)+(1.024)+(5.011), (I-749)+(1.024)+(5.012), (I-749)+(1.024)+(5.013), (I-749)+(1.024)+(5.014), (I-749)+(1.024)+(5.015), (I-749)+(1.024)+(5.016), (I-749)+(1.024)+(5.017), (I-749)+(1.024)+(5.018), (I-749)+(1.024)+(5.019), (I-749)+(1.024)+(5.020), (I-749)+(1.024)+(5.021), (I-749)+(1.024)+(5.022), (I-749)+(1.024)+(5.023), (I-749)+(1.024)+(6.001), (I-749)+(1.024)+(6.002), (I-749)+(1.024)+(6.003), (I-749)+(1.024)+(6.004), (I-749)+(1.024)+(7.001), (I-749)+(1.024)+(7.002), (I-749)+(1.024)+(7.003), (I-749)+(1.024)+(7.004), (I-749)+(1.024)+(7.005), (I-749)+(1.024)+(7.006), (I-749)+(1.024)+(9.001), (I-749)+(1.024)+(9.002), (I-749)+(1.024)+(9.003), (I-749)+(1.024)+(9.004), (I-749)+(1.024)+(9.005), (I-749)+(1.024)+(9.006), (I-749)+(1.024)+(9.007), (I-749)+(1.024)+(9.008), (I-749)+(1.024)+(9.009), (I-749)+(1.024)+(14.001), (I-749)+(1.024)+(14.002), (I-749)+(1.024)+(15.008), (I-749)+(1.024)+(15.011), (I-749)+(1.024)+(15.012), (I-749)+(1.024)+(15.016), (I-749)+(1.024)+(15.025), (I-749)+(1.024)+(15.027), (I-749)+(1.024)+(15.047), (I-749)+(1.024)+(15.063), (I-749)+(1.024)+(15.064), (I-749)+(1.024)+(16.001), (I-749)+(1.024)+(16.002), (I-749)+(1.024)+(16.003), (I-749)+(1.024)+(16.004), (I-749)+(1.024)+(16.005), (I-749)+(1.024)+(16.006), (I-749)+(1.024)+(16.007), (I-749)+(1.024)+(16.008), (I-749)+(1.024)+(17.001), (I-749)+(1.024)+(17.002), (I-749)+(1.024)+(17.003), (I-749)+(1.024)+(17.004), (I-749)+(1.024)+(17.005), (I-749)+(1.024)+(17.006), (I-749)+(1.024)+(17.007), (I-749)+(1.024)+(17.008), (I-749)+(1.024)+(17.009), (I-749)+(1.024)+(17.010), (I-749)+(1.024)+(17.011), (I-749)+(1.024)+(17.012), (I-749)+(1.024)+(18.001),

(I-749)+(1.025)+(1.026), (I-749)+(1.025)+(1.027), (I-749)+(1.025)+(1.028), (I-749)+(1.025)+(1.029), (I-749)+(1.025)+(1.030), (I-749)+(1.025)+(1.031), (I-749)+(1.025)+(1.032), (I-749)+(1.025)+(1.033), (I-749)+(1.025)+(1.034), (I-749)+(1.025)+(1.035), (I-749)+(1.025)+(1.036), (I-749)+(1.025)+(1.037), (I-749)+(1.025)+(1.038), (I-749)+(1.025)+(1.039), (I-749)+(1.025)+(1.040), (I-749)+(1.025)+(1.041), (I-749)+(1.025)+(1.042), (I-749)+(1.025)+(1.043), (I-749)+(1.025)+(1.044), (I-749)+(1.025)+(1.045), (I-749)+(1.025)+(1.046), (I-749)+(1.025)+(1.047), (I-749)+(1.025)+(1.048), (I-749)+(1.025)+(1.049), (I-749)+(1.025)+(1.050), (I-749)+(1.025)+(1.051), (I-749)+(1.025)+(1.052), (I-749)+(1.025)+(1.053), (I-749)+(1.025)+(1.054), (I-749)+(1.025)+(1.055), (I-749)+(1.025)+(1.056), (I-749)+(1.025)+(1.057), (I-749)+(1.025)+(1.058), (I-749)+(1.025)+(1.059), (I-749)+(1.025)+(1.060), (I-749)+(1.025)+(1.061), (I-749)+(1.025)+(1.062), (I-749)+(1.025)+(1.063), (I-749)+(1.025)+(1.064), (I-749)+(1.025)+(1.065), (I-749)+(1.025)+(1.066), (I-749)+(1.025)+(1.067), (I-749)+(1.025)+(1.068), (I-749)+(1.025)+(1.069), (I-749)+(1.025)+(1.070), (I-749)+(1.025)+(1.071), (I-749)+(1.025)+(1.072), (I-749)+(1.025)+(1.073), (I-749)+(1.025)+(1.074), (I-749)+(1.025)+(1.075), (I-749)+(1.025)+(1.076), (I-749)+(1.025)+(1.077), (I-749)+(1.025)+(1.078), (I-749)+(1.025)+(1.079), (I-749)+(1.025)+(1.080), (I-749)+(1.025)+(1.081), (I-749)+(1.025)+(1.082), (I-749)+(1.025)+(1.083), (I-749)+(1.025)+(1.084), (I-749)+(1.025)+(1.085), (I-749)+(1.025)+(1.086), (I-749)+(1.025)+(1.087), (I-749)+(1.025)+(1.088), (I-749)+(1.025)+(1.089), (I-749)+(1.025)+(1.090), (I-749)+(1.025)+(1.091), (I-749)+(1.025)+(1.092), (I-749)+(1.025)+(2.001), (I-749)+(1.025)+(2.002), (I-749)+(1.025)+(2.003), (I-749)+(1.025)+(2.004), (I-749)+(1.025)+(2.005), (I-749)+(1.025)+(2.006), (I-749)+(1.025)+(2.007), (I-749)+(1.025)+(2.008), (I-749)+(1.025)+(2.009), (I-749)+(1.025)+(2.010), (I-749)+(1.025)+(2.011), (I-749)+(1.025)+(2.012), (I-749)+(1.025)+(2.013), (I-749)+(1.025)+(2.014), (I-749)+(1.025)+(2.015), (I-749)+(1.025)+(2.016), (I-749)+(1.025)+(2.017), (I-749)+(1.025)+(2.018), (I-749)+(1.025)+(2.019), (I-749)+(1.025)+(2.020), (I-749)+(1.025)+(2.021), (I-749)+(1.025)+(2.022), (I-749)+(1.025)+(2.023), (I-749)+(1.025)+(2.024), (I-749)+(1.025)+(2.025), (I-749)+(1.025)+(2.026), (I-749)+(1.025)+(2.027), (I-749)+(1.025)+(2.028), (I-749)+(1.025)+(2.029), (I-749)+(1.025)+(2.030), (I-749)+(1.025)+(2.031), (I-749)+(1.025)+(2.032), (I-749)+(1.025)+(2.033), (I-749)+(1.025)+(2.034), (I-749)+(1.025)+(2.035), (I-749)+(1.025)+(2.036), (I-749)+(1.025)+(2.037), (I-749)+(1.025)+(2.038), (I-749)+(1.025)+(2.039), (I-749)+(1.025)+(2.040), (I-749)+(1.025)+(2.041), (I-749)+(1.025)+(2.042), (I-749)+(1.025)+(2.043), (I-749)+(1.025)+(2.044), (I-749)+(1.025)+(2.045), (I-749)+(1.025)+(2.046), (I-749)+(1.025)+(2.047), (I-749)+(1.025)+(2.048), (I-749)+(1.025)+(2.049), (I-749)+(1.025)+(2.050), (I-749)+(1.025)+(2.051), (I-749)+(1.025)+(2.052), (I-749)+(1.025)+(2.053), (I-749)+(1.025)+(2.054), (I-749)+(1.025)+(2.055), (I-749)+(1.025)+(2.056), (I-749)+(1.025)+(2.057), (I-749)+(1.025)+(2.058), (I-749)+(1.025)+(2.059), (I-749)+(1.025)+(3.001), (I-749)+(1.025)+(3.002), (I-749)+(1.025)+(3.003), (I-749)+(1.025)+(3.004), (I-749)+(1.025)+(3.005), (I-749)+(1.025)+(3.006), (I-749)+(1.025)+(3.007), (I-749)+(1.025)+(3.008), (I-749)+(1.025)+(3.009), (I-749)+(1.025)+(3.010), (I-749)+(1.025)+(3.011), (I-749)+(1.025)+(3.012), (I-749)+(1.025)+(3.013), (I-749)+(1.025)+(3.014), (I-749)+(1.025)+(3.015), (I-749)+(1.025)+(3.016), (I-749)+(1.025)+(3.017), (I-749)+(1.025)+(3.018), (I-749)+(1.025)+(3.019), (I-749)+(1.025)+(3.020), (I-749)+(1.025)+(3.021), (I-749)+(1.025)+(3.022), (I-749)+(1.025)+(3.023), (I-749)+(1.025)+(3.024), (I-749)+(1.025)+(3.025), (I-749)+(1.025)+(3.026), (I-749)+(1.025)+(3.027), (I-749)+(1.025)+(3.028), (I-749)+(1.025)+(3.029), (I-749)+(1.025)+(3.030), (I-749)+(1.025)+(3.031), (I-749)+(1.025)+(5.001), (I-749)+(1.025)+(5.002), (I-749)+(1.025)+(5.003), (I-749)+(1.025)+(5.004), (I-749)+(1.025)+(5.005), (I-749)+(1.025)+(5.006), (I-749)+(1.025)+(5.007), (I-749)+(1.025)+(5.008), (I-749)+(1.025)+(5.009), (I-749)+(1.025)+(5.010), (I-749)+(1.025)+(5.011), (I-749)+(1.025)+(5.012), (I-749)+(1.025)+(5.013), (I-749)+(1.025)+(5.014), (I-749)+(1.025)+(5.015), (I-749)+(1.025)+(5.016), (I-749)+(1.025)+(5.017), (I-749)+(1.025)+(5.018), (I-749)+(1.025)+(5.019), (I-749)+(1.025)+(5.020), (I-749)+(1.025)+(5.021), (I-749)+(1.025)+(5.022), (I-749)+(1.025)+(5.023), (I-749)+(1.025)+(6.001), (I-749)+(1.025)+(6.002), (I-749)+(1.025)+(6.003), (I-749)+(1.025)+(6.004), (I-749)+(1.025)+(7.001), (I-749)+(1.025)+(7.002), (I-749)+(1.025)+(7.003), (I-749)+(1.025)+(7.004), (I-749)+(1.025)+(7.005), (I-749)+(1.025)+(7.006), (I-749)+(1.025)+(9.001), (I-749)+(1.025)+(9.002), (I-749)+(1.025)+(9.003), (I-749)+(1.025)+(9.004), (I-749)+(1.025)+(9.005), (I-749)+(1.025)+(9.006), (I-749)+(1.025)+(9.007), (I-749)+(1.025)+(9.008), (I-749)+(1.025)+(9.009), (I-749)+(1.025)+(14.001), (I-749)+(1.025)+(14.002), (I-749)+(1.025)+(15.008), (I-749)+(1.025)+(15.011), (I-749)+(1.025)+(15.012), (I-749)+(1.025)+(15.016), (I-749)+(1.025)+(15.025), (I-749)+(1.025)+(15.027), (I-749)+(1.025)+(15.047), (I-749)+(1.025)+(15.063), (I-749)+(1.025)+(15.064), (I-749)+(1.025)+(16.001), (I-749)+(1.025)+(16.002), (I-749)+(1.025)+(16.003), (I-749)+(1.025)+(16.004), (I-749)+(1.025)+(16.005), (I-749)+(1.025)+(16.006), (I-749)+(1.025)+(16.007), (I-749)+(1.025)+(16.008), (I-749)+(1.025)+(17.001), (I-749)+(1.025)+(17.002), (I-749)+(1.025)+(17.003), (I-749)+(1.025)+(17.004), (I-749)+(1.025)+(17.005), (I-749)+(1.025)+(17.006), (I-749)+(1.025)+(17.007), (I-749)+(1.025)+(17.008), (I-749)+(1.025)+(17.009), (I-749)+(1.025)+(17.010), (I-749)+(1.025)+(17.011), (I-749)+(1.025)+(17.012), (I-749)+(1.025)+(18.001),

(I-749)+(1.026)+(1.027), (I-749)+(1.026)+(1.028), (I-749)+(1.026)+(1.029), (I-749)+(1.026)+(1.030), (I-749)+(1.026)+(1.031), (I-749)+(1.026)+(1.032), (I-749)+(1.026)+(1.033), (I-749)+(1.026)+(1.034), (I-749)+(1.026)+(1.035), (I-749)+(1.026)+(1.036), (I-749)+(1.026)+(1.037), (I-749)+(1.026)+(1.038), (I-749)+(1.026)+(1.039), (I-749)+(1.026)+(1.040), (I-749)+(1.026)+(1.041), (I-749)+(1.026)+(1.042), (I-749)+(1.026)+(1.043), (I-749)+(1.026)+(1.044), (I-749)+(1.026)+(1.045), (I-749)+(1.026)+(1.046), (I-749)+(1.026)+(1.047), (I-749)+(1.026)+(1.048), (I-749)+(1.026)+(1.049), (I-749)+(1.026)+(1.050), (I-749)+(1.026)+(1.051), (I-749)+(1.026)+(1.052), (I-749)+(1.026)+(1.053), (I-749)+(1.026)+(1.054), (I-749)+(1.026)+(1.055), (I-749)+(1.026)+(1.056), (I-749)+(1.026)+(1.057), (I-749)+(1.026)+(1.058), (I-749)+(1.026)+(1.059), (I-749)+(1.026)+(1.060), (I-749)+(1.026)+(1.061), (I-749)+(1.026)+(1.062), (I-749)+(1.026)+(1.063), (I-749)+(1.026)+(1.064), (I-749)+(1.026)+(1.065), (I-749)+(1.026)+(1.066), (I-749)+(1.026)+(1.067), (I-749)+(1.026)+(1.068), (I-749)+(1.026)+(1.069), (I-749)+(1.026)+(1.070), (I-749)+(1.026)+(1.071), (I-749)+(1.026)+(1.072), (I-749)+(1.026)+(1.073), (I-749)+(1.026)+(1.074), (I-749)+(1.026)+(1.075), (I-749)+(1.026)+(1.076), (I-749)+(1.026)+(1.077), (I-749)+(1.026)+(1.078), (I-749)+(1.026)+(1.079), (I-749)+(1.026)+(1.080), (I-749)+(1.026)+(1.081), (I-749)+(1.026)+(1.082), (I-749)+(1.026)+(1.083), (I-749)+(1.026)+(1.084), (I-749)+(1.026)+(1.085), (I-749)+(1.026)+(1.086), (I-749)+(1.026)+(1.087), (I-749)+(1.026)+(1.088), (I-749)+(1.026)+(1.089), (I-749)+(1.026)+(1.090), (I-749)+(1.026)+(1.091), (I-749)+(1.026)+(1.092), (I-749)+(1.026)+(2.001), (I-749)+(1.026)+(2.002), (I-749)+(1.026)+(2.003), (I-749)+(1.026)+(2.004), (I-749)+(1.026)+(2.005), (I-749)+(1.026)+(2.006), (I-749)+(1.026)+(2.007), (I-749)+(1.026)+(2.008), (I-749)+(1.026)+(2.009), (I-749)+(1.026)+(2.010), (I-749)+(1.026)+(2.011), (I-749)+(1.026)+(2.012), (I-749)+(1.026)+(2.013), (I-749)+(1.026)+(2.014), (I-749)+(1.026)+(2.015), (I-749)+(1.026)+(2.016), (I-749)+(1.026)+(2.017), (I-749)+(1.026)+(2.018), (I-749)+(1.026)+(2.019), (I-749)+(1.026)+(2.020), (I-749)+(1.026)+(2.021), (I-749)+(1.026)+(2.022), (I-749)+(1.026)+(2.023), (I-749)+(1.026)+(2.024), (I-749)+(1.026)+(2.025), (I-749)+(1.026)+(2.026), (I-749)+(1.026)+(2.027), (I-749)+(1.026)+(2.028), (I-749)+(1.026)+(2.029), (I-749)+(1.026)+(2.030), (I-749)+(1.026)+(2.031), (I-749)+(1.026)+(2.032), (I-749)+(1.026)+(2.033), (I-749)+(1.026)+(2.034), (I-749)+(1.026)+(2.035), (I-749)+(1.026)+(2.036), (I-749)+(1.026)+(2.037), (I-749)+(1.026)+(2.038), (I-749)+(1.026)+(2.039), (I-749)+(1.026)+(2.040), (I-749)+(1.026)+(2.041), (I-749)+(1.026)+(2.042), (I-749)+(1.026)+(2.043), (I-749)+(1.026)+(2.044), (I-749)+(1.026)+(2.045), (I-749)+(1.026)+(2.046), (I-749)+(1.026)+(2.047), (I-749)+(1.026)+(2.048), (I-749)+(1.026)+(2.049), (I-749)+(1.026)+(2.050), (I-749)+(1.026)+(2.051), (I-749)+(1.026)+(2.052), (I-749)+(1.026)+(2.053), (I-749)+(1.026)+(2.054), (I-749)+(1.026)+(2.055), (I-749)+(1.026)+(2.056), (I-749)+(1.026)+(2.057), (I-749)+(1.026)+(2.058), (I-749)+(1.026)+(2.059), (I-749)+(1.026)+(3.001), (I-749)+(1.026)+(3.002), (I-749)+(1.026)+(3.003), (I-749)+(1.026)+(3.004), (I-749)+(1.026)+(3.005), (I-749)+(1.026)+(3.006), (I-749)+(1.026)+(3.007), (I-749)+(1.026)+(3.008), (I-749)+(1.026)+(3.009), (I-749)+(1.026)+(3.010), (I-749)+(1.026)+(3.011), (I-749)+(1.026)+(3.012), (I-749)+(1.026)+(3.013), (I-749)+(1.026)+(3.014), (I-749)+(1.026)+(3.015), (I-749)+(1.026)+(3.016), (I-749)+(1.026)+(3.017), (I-749)+(1.026)+(3.018), (I-749)+(1.026)+(3.019), (I-749)+(1.026)+(3.020), (I-749)+(1.026)+(3.021), (I-749)+(1.026)+(3.022), (I-749)+(1.026)+(3.023), (I-749)+(1.026)+(3.024), (I-749)+(1.026)+(3.025), (I-749)+(1.026)+(3.026), (I-749)+(1.026)+(3.027), (I-749)+(1.026)+(3.028), (I-749)+(1.026)+(3.029), (I-749)+(1.026)+(3.030), (I-749)+(1.026)+(3.031), (I-749)+(1.026)+(5.001), (I-749)+(1.026)+(5.002), (I-749)+(1.026)+(5.003), (I-749)+(1.026)+(5.004), (I-749)+(1.026)+(5.005), (I-749)+(1.026)+(5.006), (I-749)+(1.026)+(5.007), (I-749)+(1.026)+(5.008), (I-749)+(1.026)+(5.009), (I-749)+(1.026)+(5.010), (I-749)+(1.026)+(5.011), (I-749)+(1.026)+(5.012), (I-749)+(1.026)+(5.013), (I-749)+(1.026)+(5.014), (I-749)+(1.026)+(5.015), (I-749)+(1.026)+(5.016), (I-749)+(1.026)+(5.017), (I-749)+(1.026)+(5.018), (I-749)+(1.026)+(5.019), (I-749)+(1.026)+(5.020), (I-749)+(1.026)+(5.021), (I-749)+(1.026)+(5.022), (I-749)+(1.026)+(5.023), (I-749)+(1.026)+(6.001), (I-749)+(1.026)+(6.002), (I-749)+(1.026)+(6.003), (I-749)+(1.026)+(6.004), (I-749)+(1.026)+(7.001), (I-749)+(1.026)+(7.002), (I-749)+(1.026)+(7.003), (I-749)+(1.026)+(7.004), (I-749)+(1.026)+(7.005), (I-749)+(1.026)+(7.006), (I-749)+(1.026)+(9.001), (I-749)+(1.026)+(9.002), (I-749)+(1.026)+(9.003), (I-749)+(1.026)+(9.004), (I-749)+(1.026)+(9.005), (I-749)+(1.026)+(9.006), (I-749)+(1.026)+(9.007), (I-749)+(1.026)+(9.008), (I-749)+(1.026)+(9.009), (I-749)+(1.026)+(14.001), (I-749)+(1.026)+(14.002), (I-749)+(1.026)+(15.008), (I-749)+(1.026)+(15.011), (I-749)+(1.026)+(15.012), (I-749)+(1.026)+(15.016), (I-749)+(1.026)+(15.025), (I-749)+(1.026)+(15.027), (I-749)+(1.026)+(15.047), (I-749)+(1.026)+(15.063), (I-749)+(1.026)+(15.064), (I-749)+(1.026)+(16.001), (I-749)+(1.026)+(16.002), (I-749)+(1.026)+(16.003), (I-749)+(1.026)+(16.004), (I-749)+(1.026)+(16.005), (I-749)+(1.026)+(16.006), (I-749)+(1.026)+(16.007), (I-749)+(1.026)+(16.008), (I-749)+(1.026)+(17.001), (I-749)+(1.026)+(17.002), (I-749)+(1.026)+(17.003), (I-749)+(1.026)+(17.004), (I-749)+(1.026)+(17.005), (I-749)+(1.026)+(17.006), (I-749)+(1.026)+(17.007), (I-749)+(1.026)+(17.008), (I-749)+(1.026)+(17.009), (I-749)+(1.026)+(17.010), (I-749)+(1.026)+(17.011), (I-749)+(1.026)+(17.012), (I-749)+(1.026)+(18.001),

(I-749)+(1.027)+(1.028), (I-749)+(1.027)+(1.029), (I-749)+(1.027)+(1.030), (I-749)+(1.027)+(1.031), (I-749)+(1.027)+(1.032), (I-749)+(1.027)+(1.033), (I-749)+(1.027)+(1.034), (I-749)+(1.027)+(1.035), (I-749)+(1.027)+(1.036), (I-749)+(1.027)+(1.037), (I-749)+(1.027)+(1.038), (I-749)+(1.027)+(1.039), (I-749)+(1.027)+(1.040), (I-749)+(1.027)+(1.041), (I-749)+(1.027)+(1.042), (I-749)+(1.027)+(1.043), (I-749)+(1.027)+(1.044), (I-749)+(1.027)+(1.045), (I-749)+(1.027)+(1.046), (I-749)+(1.027)+(1.047), (I-749)+(1.027)+(1.048), (I-749)+(1.027)+(1.049), (I-749)+(1.027)+(1.050), (I-749)+(1.027)+(1.051), (I-749)+(1.027)+(1.052), (I-749)+(1.027)+(1.053), (I-749)+(1.027)+(1.054), (I-749)+(1.027)+(1.055), (I-749)+(1.027)+(1.056), (I-749)+(1.027)+(1.057), (I-749)+(1.027)+(1.058), (I-749)+(1.027)+(1.059), (I-749)+(1.027)+(1.060), (I-749)+(1.027)+(1.061), (I-749)+(1.027)+(1.062), (I-749)+(1.027)+(1.063), (I-749)+(1.027)+(1.064), (I-749)+(1.027)+(1.065), (I-749)+(1.027)+(1.066), (I-749)+(1.027)+(1.067), (I-749)+(1.027)+(1.068), (I-749)+(1.027)+(1.069), (I-749)+(1.027)+(1.070), (I-749)+(1.027)+(1.071), (I-749)+(1.027)+(1.072), (I-749)+(1.027)+(1.073), (I-749)+(1.027)+(1.074), (I-749)+(1.027)+(1.075), (I-749)+(1.027)+(1.076), (I-749)+(1.027)+(1.077), (I-749)+(1.027)+(1.078), (I-749)+(1.027)+(1.079), (I-749)+(1.027)+(1.080), (I-749)+(1.027)+(1.081), (I-749)+(1.027)+(1.082), (I-749)+(1.027)+(1.083), (I-749)+(1.027)+(1.084), (I-749)+(1.027)+(1.085), (I-749)+(1.027)+(1.086), (I-749)+(1.027)+(1.087), (I-749)+(1.027)+(1.088), (I-749)+(1.027)+(1.089), (I-749)+(1.027)+(1.090), (I-749)+(1.027)+(1.091), (I-749)+(1.027)+(1.092), (I-749)+(1.027)+(2.001), (I-749)+(1.027)+(2.002), (I-749)+(1.027)+(2.003), (I-749)+(1.027)+(2.004), (I-749)+(1.027)+(2.005), (I-749)+(1.027)+(2.006), (I-749)+(1.027)+(2.007), (I-749)+(1.027)+(2.008), (I-749)+(1.027)+(2.009), (I-749)+(1.027)+(2.010), (I-749)+(1.027)+(2.011), (I-749)+(1.027)+(2.012), (I-749)+(1.027)+(2.013), (I-749)+(1.027)+(2.014), (I-749)+(1.027)+(2.015), (I-749)+(1.027)+(2.016), (I-749)+(1.027)+(2.017), (I-749)+(1.027)+(2.018), (I-749)+(1.027)+(2.019), (I-749)+(1.027)+(2.020), (I-749)+(1.027)+(2.021), (I-749)+(1.027)+(2.022), (I-749)+(1.027)+(2.023), (I-749)+(1.027)+(2.024), (I-749)+(1.027)+(2.025), (I-749)+(1.027)+(2.026), (I-749)+(1.027)+(2.027), (I-749)+(1.027)+(2.028), (I-749)+(1.027)+(2.029), (I-749)+(1.027)+(2.030), (I-749)+(1.027)+(2.031), (I-749)+(1.027)+(2.032), (I-749)+(1.027)+(2.033), (I-749)+(1.027)+(2.034), (I-749)+(1.027)+(2.035), (I-749)+(1.027)+(2.036), (I-749)+(1.027)+(2.037), (I-749)+(1.027)+(2.038), (I-749)+(1.027)+(2.039), (I-749)+(1.027)+(2.040), (I-749)+(1.027)+(2.041), (I-749)+(1.027)+(2.042), (I-749)+(1.027)+(2.043), (I-749)+(1.027)+(2.044), (I-749)+(1.027)+(2.045), (I-749)+(1.027)+(2.046), (I-749)+(1.027)+(2.047), (I-749)+(1.027)+(2.048), (I-749)+(1.027)+(2.049), (I-749)+(1.027)+(2.050), (I-749)+(1.027)+(2.051), (I-749)+(1.027)+(2.052), (I-749)+(1.027)+(2.053), (I-749)+(1.027)+(2.054), (I-749)+(1.027)+(2.055), (I-749)+(1.027)+(2.056), (I-749)+(1.027)+(2.057), (I-749)+(1.027)+(2.058), (I-749)+(1.027)+(2.059), (I-749)+(1.027)+(3.001), (I-749)+(1.027)+(3.002), (I-749)+(1.027)+(3.003), (I-749)+(1.027)+(3.004), (I-749)+(1.027)+(3.005), (I-749)+(1.027)+(3.006), (I-749)+(1.027)+(3.007), (I-749)+(1.027)+(3.008), (I-749)+(1.027)+(3.009), (I-749)+(1.027)+(3.010), (I-749)+(1.027)+(3.011), (I-749)+(1.027)+(3.012), (I-749)+(1.027)+(3.013), (I-749)+(1.027)+(3.014), (I-749)+(1.027)+(3.015), (I-749)+(1.027)+(3.016), (I-749)+(1.027)+(3.017), (I-749)+(1.027)+(3.018), (I-749)+(1.027)+(3.019), (I-749)+(1.027)+(3.020), (I-749)+(1.027)+(3.021), (I-749)+(1.027)+(3.022), (I-749)+(1.027)+(3.023), (I-749)+(1.027)+(3.024), (I-749)+(1.027)+(3.025), (I-749)+(1.027)+(3.026), (I-749)+(1.027)+(3.027), (I-749)+(1.027)+(3.028), (I-749)+(1.027)+(3.029), (I-749)+(1.027)+(3.030), (I-749)+(1.027)+(3.031), (I-749)+(1.027)+(5.001), (I-749)+(1.027)+(5.002), (I-749)+(1.027)+(5.003), (I-749)+(1.027)+(5.004), (I-749)+(1.027)+(5.005), (I-749)+(1.027)+(5.006), (I-749)+(1.027)+(5.007), (I-749)+(1.027)+(5.008), (I-749)+(1.027)+(5.009), (I-749)+(1.027)+(5.010), (I-749)+(1.027)+(5.011), (I-749)+(1.027)+(5.012), (I-749)+(1.027)+(5.013), (I-749)+(1.027)+(5.014), (I-749)+(1.027)+(5.015), (I-749)+(1.027)+(5.016), (I-749)+(1.027)+(5.017), (I-749)+(1.027)+(5.018), (I-749)+(1.027)+(5.019), (I-749)+(1.027)+(5.020), (I-749)+(1.027)+(5.021), (I-749)+(1.027)+(5.022), (I-749)+(1.027)+(5.023), (I-749)+(1.027)+(6.001), (I-749)+(1.027)+(6.002), (I-749)+(1.027)+(6.003), (I-749)+(1.027)+(6.004), (I-749)+(1.027)+(7.001), (I-749)+(1.027)+(7.002), (I-749)+(1.027)+(7.003), (I-749)+(1.027)+(7.004), (I-749)+(1.027)+(7.005), (I-749)+(1.027)+(7.006), (I-749)+(1.027)+(9.001), (I-749)+(1.027)+(9.002), (I-749)+(1.027)+(9.003), (I-749)+(1.027)+(9.004), (I-749)+(1.027)+(9.005), (I-749)+(1.027)+(9.006), (I-749)+(1.027)+(9.007), (I-749)+(1.027)+(9.008), (I-749)+(1.027)+(9.009), (I-749)+(1.027)+(14.001), (I-749)+(1.027)+(14.002), (I-749)+(1.027)+(15.008), (I-749)+(1.027)+(15.011), (I-749)+(1.027)+(15.012), (I-749)+(1.027)+(15.016), (I-749)+(1.027)+(15.025), (I-749)+(1.027)+(15.027), (I-749)+(1.027)+(15.047), (I-749)+(1.027)+(15.063), (I-749)+(1.027)+(15.064), (I-749)+(1.027)+(16.001), (I-749)+(1.027)+(16.002), (I-749)+(1.027)+(16.003), (I-749)+(1.027)+(16.004), (I-749)+(1.027)+(16.005), (I-749)+(1.027)+(16.006), (I-749)+(1.027)+(16.007), (I-749)+(1.027)+(16.008), (I-749)+(1.027)+(17.001), (I-749)+(1.027)+(17.002), (I-749)+(1.027)+(17.003), (I-749)+(1.027)+(17.004), (I-749)+(1.027)+(17.005), (I-749)+(1.027)+(17.006), (I-749)+(1.027)+(17.007), (I-749)+(1.027)+(17.008), (I-749)+(1.027)+(17.009), (I-749)+(1.027)+(17.010), (I-749)+(1.027)+(17.011), (I-749)+(1.027)+(17.012), (I-749)+(1.027)+(18.001),

(I-749)+(1.028)+(1.029), (I-749)+(1.028)+(1.030), (I-749)+(1.028)+(1.031), (I-749)+(1.028)+(1.032), (I-749)+(1.028)+(1.033), (I-749)+(1.028)+(1.034), (I-749)+(1.028)+(1.035), (I-749)+(1.028)+(1.036), (I-749)+(1.028)+(1.037), (I-749)+(1.028)+(1.038), (I-749)+(1.028)+(1.039), (I-749)+(1.028)+(1.040), (I-749)+(1.028)+(1.041), (I-749)+(1.028)+(1.042), (I-749)+(1.028)+(1.043), (I-749)+(1.028)+(1.044), (I-749)+(1.028)+(1.045), (I-749)+(1.028)+(1.046), (I-749)+(1.028)+(1.047), (I-749)+(1.028)+(1.048), (I-749)+(1.028)+(1.049), (I-749)+(1.028)+(1.050), (I-749)+(1.028)+(1.051), (I-749)+(1.028)+(1.052), (I-749)+(1.028)+(1.053), (I-749)+(1.028)+(1.054), (I-749)+(1.028)+(1.055), (I-749)+(1.028)+(1.056), (I-749)+(1.028)+(1.057), (I-749)+(1.028)+(1.058), (I-749)+(1.028)+(1.059), (I-749)+(1.028)+(1.060), (I-749)+(1.028)+(1.061), (I-749)+(1.028)+(1.062), (I-749)+(1.028)+(1.063), (I-749)+(1.028)+(1.064), (I-749)+(1.028)+(1.065), (I-749)+(1.028)+(1.066), (I-749)+(1.028)+(1.067), (I-749)+(1.028)+(1.068), (I-749)+(1.028)+(1.069), (I-749)+(1.028)+(1.070), (I-749)+(1.028)+(1.071), (I-749)+(1.028)+(1.072), (I-749)+(1.028)+(1.073), (I-749)+(1.028)+(1.074), (I-749)+(1.028)+(1.075), (I-749)+(1.028)+(1.076), (I-749)+(1.028)+(1.077), (I-749)+(1.028)+(1.078), (I-749)+(1.028)+(1.079), (I-749)+(1.028)+(1.080), (I-749)+(1.028)+(1.081), (I-749)+(1.028)+(1.082), (I-749)+(1.028)+(1.083), (I-749)+(1.028)+(1.084), (I-749)+(1.028)+(1.085), (I-749)+(1.028)+(1.086), (I-749)+(1.028)+(1.087), (I-749)+(1.028)+(1.088), (I-749)+(1.028)+(1.089), (I-749)+(1.028)+(1.090), (I-749)+(1.028)+(1.091), (I-749)+(1.028)+(1.092), (I-749)+(1.028)+(2.001), (I-749)+(1.028)+(2.002), (I-749)+(1.028)+(2.003), (I-749)+(1.028)+(2.004), (I-749)+(1.028)+(2.005), (I-749)+(1.028)+(2.006), (I-749)+(1.028)+(2.007), (I-749)+(1.028)+(2.008), (I-749)+(1.028)+(2.009), (I-749)+(1.028)+(2.010), (I-749)+(1.028)+(2.011), (I-749)+(1.028)+(2.012), (I-749)+(1.028)+(2.013), (I-749)+(1.028)+(2.014), (I-749)+(1.028)+(2.015), (I-749)+(1.028)+(2.016), (I-749)+(1.028)+(2.017), (I-749)+(1.028)+(2.018), (I-749)+(1.028)+(2.019), (I-749)+(1.028)+(2.020), (I-749)+(1.028)+(2.021), (I-749)+(1.028)+(2.022), (I-749)+(1.028)+(2.023), (I-749)+(1.028)+(2.024), (I-749)+(1.028)+(2.025), (I-749)+(1.028)+(2.026), (I-749)+(1.028)+(2.027), (I-749)+(1.028)+(2.028), (I-749)+(1.028)+(2.029), (I-749)+(1.028)+(2.030), (I-749)+(1.028)+(2.031), (I-749)+(1.028)+(2.032), (I-749)+(1.028)+(2.033), (I-749)+(1.028)+(2.034), (I-749)+(1.028)+(2.035), (I-749)+(1.028)+(2.036), (I-749)+(1.028)+(2.037), (I-749)+(1.028)+(2.038), (I-749)+(1.028)+(2.039), (I-749)+(1.028)+(2.040), (I-749)+(1.028)+(2.041), (I-749)+(1.028)+(2.042), (I-749)+(1.028)+(2.043), (I-749)+(1.028)+(2.044), (I-749)+(1.028)+(2.045), (I-749)+(1.028)+(2.046), (I-749)+(1.028)+(2.047), (I-749)+(1.028)+(2.048), (I-749)+(1.028)+(2.049), (I-749)+(1.028)+(2.050), (I-749)+(1.028)+(2.051), (I-749)+(1.028)+(2.052), (I-749)+(1.028)+(2.053), (I-749)+(1.028)+(2.054), (I-749)+(1.028)+(2.055), (I-749)+(1.028)+(2.056), (I-749)+(1.028)+(2.057), (I-749)+(1.028)+(2.058), (I-749)+(1.028)+(2.059), (I-749)+(1.028)+(3.001), (I-749)+(1.028)+(3.002), (I-749)+(1.028)+(3.003), (I-749)+(1.028)+(3.004), (I-749)+(1.028)+(3.005), (I-749)+(1.028)+(3.006), (I-749)+(1.028)+(3.007), (I-749)+(1.028)+(3.008), (I-749)+(1.028)+(3.009), (I-749)+(1.028)+(3.010), (I-749)+(1.028)+(3.011), (I-749)+(1.028)+(3.012), (I-749)+(1.028)+(3.013), (I-749)+(1.028)+(3.014), (I-749)+(1.028)+(3.015), (I-749)+(1.028)+(3.016), (I-749)+(1.028)+(3.017), (I-749)+(1.028)+(3.018), (I-749)+(1.028)+(3.019), (I-749)+(1.028)+(3.020), (I-749)+(1.028)+(3.021), (I-749)+(1.028)+(3.022), (I-749)+(1.028)+(3.023), (I-749)+(1.028)+(3.024), (I-749)+(1.028)+(3.025), (I-749)+(1.028)+(3.026), (I-749)+(1.028)+(3.027), (I-749)+(1.028)+(3.028), (I-749)+(1.028)+(3.029), (I-749)+(1.028)+(3.030), (I-749)+(1.028)+(3.031), (I-749)+(1.028)+(5.001), (I-749)+(1.028)+(5.002), (I-749)+(1.028)+(5.003), (I-749)+(1.028)+(5.004), (I-749)+(1.028)+(5.005), (I-749)+(1.028)+(5.006), (I-749)+(1.028)+(5.007), (I-749)+(1.028)+(5.008), (I-749)+(1.028)+(5.009), (I-749)+(1.028)+(5.010), (I-749)+(1.028)+(5.011), (I-749)+(1.028)+(5.012), (I-749)+(1.028)+(5.013), (I-749)+(1.028)+(5.014), (I-749)+(1.028)+(5.015), (I-749)+(1.028)+(5.016), (I-749)+(1.028)+(5.017), (I-749)+(1.028)+(5.018), (I-749)+(1.028)+(5.019), (I-749)+(1.028)+(5.020), (I-749)+(1.028)+(5.021), (I-749)+(1.028)+(5.022), (I-749)+(1.028)+(5.023), (I-749)+(1.028)+(6.001), (I-749)+(1.028)+(6.002), (I-749)+(1.028)+(6.003), (I-749)+(1.028)+(6.004), (I-749)+(1.028)+(7.001), (I-749)+(1.028)+(7.002), (I-749)+(1.028)+(7.003), (I-749)+(1.028)+(7.004), (I-749)+(1.028)+(7.005), (I-749)+(1.028)+(7.006), (I-749)+(1.028)+(9.001), (I-749)+(1.028)+(9.002), (I-749)+(1.028)+(9.003), (I-749)+(1.028)+(9.004), (I-749)+(1.028)+(9.005), (I-749)+(1.028)+(9.006), (I-749)+(1.028)+(9.007), (I-749)+(1.028)+(9.008), (I-749)+(1.028)+(9.009), (I-749)+(1.028)+(14.001), (I-749)+(1.028)+(14.002), (I-749)+(1.028)+(15.008), (I-749)+(1.028)+(15.011), (I-749)+(1.028)+(15.012), (I-749)+(1.028)+(15.016), (I-749)+(1.028)+(15.025), (I-749)+(1.028)+(15.027), (I-749)+(1.028)+(15.047), (I-749)+(1.028)+(15.063), (I-749)+(1.028)+(15.064), (I-749)+(1.028)+(16.001), (I-749)+(1.028)+(16.002), (I-749)+(1.028)+(16.003), (I-749)+(1.028)+(16.004), (I-749)+(1.028)+(16.005), (I-749)+(1.028)+(16.006), (I-749)+(1.028)+(16.007), (I-749)+(1.028)+(16.008), (I-749)+(1.028)+(17.001), (I-749)+(1.028)+(17.002), (I-749)+(1.028)+(17.003), (I-749)+(1.028)+(17.004), (I-749)+(1.028)+(17.005), (I-749)+(1.028)+(17.006), (I-749)+(1.028)+(17.007), (I-749)+(1.028)+(17.008), (I-749)+(1.028)+(17.009), (I-749)+(1.028)+(17.010), (I-749)+(1.028)+(17.011), (I-749)+(1.028)+(17.012), (I-749)+(1.028)+(18.001),

(I-749)+(1.029)+(1.030), (I-749)+(1.029)+(1.031), (I-749)+(1.029)+(1.032), (I-749)+(1.029)+(1.033), (I-749)+(1.029)+(1.034), (I-749)+(1.029)+(1.035), (I-749)+(1.029)+(1.036), (I-749)+(1.029)+(1.037), (I-749)+(1.029)+(1.038), (I-749)+(1.029)+(1.039), (I-749)+(1.029)+(1.040), (I-749)+(1.029)+(1.041), (I-749)+(1.029)+(1.042), (I-749)+(1.029)+(1.043), (I-749)+(1.029)+(1.044), (I-749)+(1.029)+(1.045), (I-749)+(1.029)+(1.046), (I-749)+(1.029)+(1.047), (I-749)+(1.029)+(1.048), (I-749)+(1.029)+(1.049), (I-749)+(1.029)+(1.050), (I-749)+(1.029)+(1.051), (I-749)+(1.029)+(1.052), (I-749)+(1.029)+(1.053), (I-749)+(1.029)+(1.054), (I-749)+(1.029)+(1.055), (I-749)+(1.029)+(1.056), (I-749)+(1.029)+(1.057), (I-749)+(1.029)+(1.058), (I-749)+(1.029)+(1.059), (I-749)+(1.029)+(1.060), (I-749)+(1.029)+(1.061), (I-749)+(1.029)+(1.062), (I-749)+(1.029)+(1.063), (I-749)+(1.029)+(1.064), (I-749)+(1.029)+(1.065), (I-749)+(1.029)+(1.066), (I-749)+(1.029)+(1.067), (I-749)+(1.029)+(1.068), (I-749)+(1.029)+(1.069), (I-749)+(1.029)+(1.070), (I-749)+(1.029)+(1.071), (I-749)+(1.029)+(1.072), (I-749)+(1.029)+(1.073), (I-749)+(1.029)+(1.074), (I-749)+(1.029)+(1.075), (I-749)+(1.029)+(1.076), (I-749)+(1.029)+(1.077), (I-749)+(1.029)+(1.078), (I-749)+(1.029)+(1.079), (I-749)+(1.029)+(1.080), (I-749)+(1.029)+(1.081), (I-749)+(1.029)+(1.082), (I-749)+(1.029)+(1.083), (I-749)+(1.029)+(1.084), (I-749)+(1.029)+(1.085), (I-749)+(1.029)+(1.086), (I-749)+(1.029)+(1.087), (I-749)+(1.029)+(1.088), (I-749)+(1.029)+(1.089), (I-749)+(1.029)+(1.090), (I-749)+(1.029)+(1.091), (I-749)+(1.029)+(1.092), (I-749)+(1.029)+(2.001), (I-749)+(1.029)+(2.002), (I-749)+(1.029)+(2.003), (I-749)+(1.029)+(2.004), (I-749)+(1.029)+(2.005), (I-749)+(1.029)+(2.006), (I-749)+(1.029)+(2.007), (I-749)+(1.029)+(2.008), (I-749)+(1.029)+(2.009), (I-749)+(1.029)+(2.010), (I-749)+(1.029)+(2.011), (I-749)+(1.029)+(2.012), (I-749)+(1.029)+(2.013), (I-749)+(1.029)+(2.014), (I-749)+(1.029)+(2.015), (I-749)+(1.029)+(2.016), (I-749)+(1.029)+(2.017), (I-749)+(1.029)+(2.018), (I-749)+(1.029)+(2.019), (I-749)+(1.029)+(2.020), (I-749)+(1.029)+(2.021), (I-749)+(1.029)+(2.022), (I-749)+(1.029)+(2.023), (I-749)+(1.029)+(2.024), (I-749)+(1.029)+(2.025), (I-749)+(1.029)+(2.026), (I-749)+(1.029)+(2.027), (I-749)+(1.029)+(2.028), (I-749)+(1.029)+(2.029), (I-749)+(1.029)+(2.030), (I-749)+(1.029)+(2.031), (I-749)+(1.029)+(2.032), (I-749)+(1.029)+(2.033), (I-749)+(1.029)+(2.034), (I-749)+(1.029)+(2.035), (I-749)+(1.029)+(2.036), (I-749)+(1.029)+(2.037), (I-749)+(1.029)+(2.038), (I-749)+(1.029)+(2.039), (I-749)+(1.029)+(2.040), (I-749)+(1.029)+(2.041), (I-749)+(1.029)+(2.042), (I-749)+(1.029)+(2.043), (I-749)+(1.029)+(2.044), (I-749)+(1.029)+(2.045), (I-749)+(1.029)+(2.046), (I-749)+(1.029)+(2.047), (I-749)+(1.029)+(2.048), (I-749)+(1.029)+(2.049), (I-749)+(1.029)+(2.050), (I-749)+(1.029)+(2.051), (I-749)+(1.029)+(2.052), (I-749)+(1.029)+(2.053), (I-749)+(1.029)+(2.054), (I-749)+(1.029)+(2.055), (I-749)+(1.029)+(2.056), (I-749)+(1.029)+(2.057), (I-749)+(1.029)+(2.058), (I-749)+(1.029)+(2.059), (I-749)+(1.029)+(3.001), (I-749)+(1.029)+(3.002), (I-749)+(1.029)+(3.003), (I-749)+(1.029)+(3.004), (I-749)+(1.029)+(3.005), (I-749)+(1.029)+(3.006), (I-749)+(1.029)+(3.007), (I-749)+(1.029)+(3.008), (I-749)+(1.029)+(3.009), (I-749)+(1.029)+(3.010), (I-749)+(1.029)+(3.011), (I-749)+(1.029)+(3.012), (I-749)+(1.029)+(3.013), (I-749)+(1.029)+(3.014), (I-749)+(1.029)+(3.015), (I-749)+(1.029)+(3.016), (I-749)+(1.029)+(3.017), (I-749)+(1.029)+(3.018), (I-749)+(1.029)+(3.019), (I-749)+(1.029)+(3.020), (I-749)+(1.029)+(3.021), (I-749)+(1.029)+(3.022), (I-749)+(1.029)+(3.023), (I-749)+(1.029)+(3.024), (I-749)+(1.029)+(3.025), (I-749)+(1.029)+(3.026), (I-749)+(1.029)+(3.027), (I-749)+(1.029)+(3.028), (I-749)+(1.029)+(3.029), (I-749)+(1.029)+(3.030), (I-749)+(1.029)+(3.031), (I-749)+(1.029)+(5.001), (I-749)+(1.029)+(5.002), (I-749)+(1.029)+(5.003), (I-749)+(1.029)+(5.004), (I-749)+(1.029)+(5.005), (I-749)+(1.029)+(5.006), (I-749)+(1.029)+(5.007), (I-749)+(1.029)+(5.008), (I-749)+(1.029)+(5.009), (I-749)+(1.029)+(5.010), (I-749)+(1.029)+(5.011), (I-749)+(1.029)+(5.012), (I-749)+(1.029)+(5.013), (I-749)+(1.029)+(5.014), (I-749)+(1.029)+(5.015), (I-749)+(1.029)+(5.016), (I-749)+(1.029)+(5.017), (I-749)+(1.029)+(5.018), (I-749)+(1.029)+(5.019), (I-749)+(1.029)+(5.020), (I-749)+(1.029)+(5.021), (I-749)+(1.029)+(5.022), (I-749)+(1.029)+(5.023), (I-749)+(1.029)+(6.001), (I-749)+(1.029)+(6.002), (I-749)+(1.029)+(6.003), (I-749)+(1.029)+(6.004), (I-749)+(1.029)+(7.001), (I-749)+(1.029)+(7.002), (I-749)+(1.029)+(7.003), (I-749)+(1.029)+(7.004), (I-749)+(1.029)+(7.005), (I-749)+(1.029)+(7.006), (I-749)+(1.029)+(9.001), (I-749)+(1.029)+(9.002), (I-749)+(1.029)+(9.003), (I-749)+(1.029)+(9.004), (I-749)+(1.029)+(9.005), (I-749)+(1.029)+(9.006), (I-749)+(1.029)+(9.007), (I-749)+(1.029)+(9.008), (I-749)+(1.029)+(9.009), (I-749)+(1.029)+(14.001), (I-749)+(1.029)+(14.002), (I-749)+(1.029)+(15.008), (I-749)+(1.029)+(15.011), (I-749)+(1.029)+(15.012), (I-749)+(1.029)+(15.016), (I-749)+(1.029)+(15.025), (I-749)+(1.029)+(15.027), (I-749)+(1.029)+(15.047), (I-749)+(1.029)+(15.063), (I-749)+(1.029)+(15.064), (I-749)+(1.029)+(16.001), (I-749)+(1.029)+(16.002), (I-749)+(1.029)+(16.003), (I-749)+(1.029)+(16.004), (I-749)+(1.029)+(16.005), (I-749)+(1.029)+(16.006), (I-749)+(1.029)+(16.007), (I-749)+(1.029)+(16.008), (I-749)+(1.029)+(17.001), (I-749)+(1.029)+(17.002), (I-749)+(1.029)+(17.003), (I-749)+(1.029)+(17.004), (I-749)+(1.029)+(17.005), (I-749)+(1.029)+(17.006), (I-749)+(1.029)+(17.007), (I-749)+(1.029)+(17.008), (I-749)+(1.029)+(17.009), (I-749)+(1.029)+(17.010), (I-749)+(1.029)+(17.011), (I-749)+(1.029)+(17.012), (I-749)+(1.029)+(18.001),

(I-749)+(1.030)+(1.031), (I-749)+(1.030)+(1.032), (I-749)+(1.030)+(1.033), (I-749)+(1.030)+(1.034), (I-749)+(1.030)+(1.035), (I-749)+(1.030)+(1.036), (I-749)+(1.030)+(1.037), (I-749)+(1.030)+(1.038), (I-749)+(1.030)+(1.039), (I-749)+(1.030)+(1.040), (I-749)+(1.030)+(1.041), (I-749)+(1.030)+(1.042), (I-749)+(1.030)+(1.043), (I-749)+(1.030)+(1.044), (I-749)+(1.030)+(1.045), (I-749)+(1.030)+(1.046), (I-749)+(1.030)+(1.047), (I-749)+(1.030)+(1.048), (I-749)+(1.030)+(1.049), (I-749)+(1.030)+(1.050), (I-749)+(1.030)+(1.051), (I-749)+(1.030)+(1.052), (I-749)+(1.030)+(1.053), (I-749)+(1.030)+(1.054), (I-749)+(1.030)+(1.055), (I-749)+(1.030)+(1.056), (I-749)+(1.030)+(1.057), (I-749)+(1.030)+(1.058), (I-749)+(1.030)+(1.059), (I-749)+(1.030)+(1.060), (I-749)+(1.030)+(1.061), (I-749)+(1.030)+(1.062), (I-749)+(1.030)+(1.063), (I-749)+(1.030)+(1.064), (I-749)+(1.030)+(1.065), (I-749)+(1.030)+(1.066), (I-749)+(1.030)+(1.067), (I-749)+(1.030)+(1.068), (I-749)+(1.030)+(1.069), (I-749)+(1.030)+(1.070), (I-749)+(1.030)+(1.071), (I-749)+(1.030)+(1.072), (I-749)+(1.030)+(1.073), (I-749)+(1.030)+(1.074), (I-749)+(1.030)+(1.075), (I-749)+(1.030)+(1.076), (I-749)+(1.030)+(1.077), (I-749)+(1.030)+(1.078), (I-749)+(1.030)+(1.079), (I-749)+(1.030)+(1.080), (I-749)+(1.030)+(1.081), (I-749)+(1.030)+(1.082), (I-749)+(1.030)+(1.083), (I-749)+(1.030)+(1.084), (I-749)+(1.030)+(1.085), (I-749)+(1.030)+(1.086), (I-749)+(1.030)+(1.087), (I-749)+(1.030)+(1.088), (I-749)+(1.030)+(1.089), (I-749)+(1.030)+(1.090), (I-749)+(1.030)+(1.091), (I-749)+(1.030)+(1.092), (I-749)+(1.030)+(2.001), (I-749)+(1.030)+(2.002), (I-749)+(1.030)+(2.003), (I-749)+(1.030)+(2.004), (I-749)+(1.030)+(2.005), (I-749)+(1.030)+(2.006), (I-749)+(1.030)+(2.007), (I-749)+(1.030)+(2.008), (I-749)+(1.030)+(2.009), (I-749)+(1.030)+(2.010), (I-749)+(1.030)+(2.011), (I-749)+(1.030)+(2.012), (I-749)+(1.030)+(2.013), (I-749)+(1.030)+(2.014), (I-749)+(1.030)+(2.015), (I-749)+(1.030)+(2.016), (I-749)+(1.030)+(2.017), (I-749)+(1.030)+(2.018), (I-749)+(1.030)+(2.019), (I-749)+(1.030)+(2.020), (I-749)+(1.030)+(2.021), (I-749)+(1.030)+(2.022), (I-749)+(1.030)+(2.023), (I-749)+(1.030)+(2.024), (I-749)+(1.030)+(2.025), (I-749)+(1.030)+(2.026), (I-749)+(1.030)+(2.027), (I-749)+(1.030)+(2.028), (I-749)+(1.030)+(2.029), (I-749)+(1.030)+(2.030), (I-749)+(1.030)+(2.031), (I-749)+(1.030)+(2.032), (I-749)+(1.030)+(2.033), (I-749)+(1.030)+(2.034), (I-749)+(1.030)+(2.035), (I-749)+(1.030)+(2.036), (I-749)+(1.030)+(2.037), (I-749)+(1.030)+(2.038), (I-749)+(1.030)+(2.039), (I-749)+(1.030)+(2.040), (I-749)+(1.030)+(2.041), (I-749)+(1.030)+(2.042), (I-749)+(1.030)+(2.043), (I-749)+(1.030)+(2.044), (I-749)+(1.030)+(2.045), (I-749)+(1.030)+(2.046), (I-749)+(1.030)+(2.047), (I-749)+(1.030)+(2.048), (I-749)+(1.030)+(2.049), (I-749)+(1.030)+(2.050), (I-749)+(1.030)+(2.051), (I-749)+(1.030)+(2.052), (I-749)+(1.030)+(2.053), (I-749)+(1.030)+(2.054), (I-749)+(1.030)+(2.055), (I-749)+(1.030)+(2.056), (I-749)+(1.030)+(2.057), (I-749)+(1.030)+(2.058), (I-749)+(1.030)+(2.059), (I-749)+(1.030)+(3.001), (I-749)+(1.030)+(3.002), (I-749)+(1.030)+(3.003), (I-749)+(1.030)+(3.004), (I-749)+(1.030)+(3.005), (I-749)+(1.030)+(3.006), (I-749)+(1.030)+(3.007), (I-749)+(1.030)+(3.008), (I-749)+(1.030)+(3.009), (I-749)+(1.030)+(3.010), (I-749)+(1.030)+(3.011), (I-749)+(1.030)+(3.012), (I-749)+(1.030)+(3.013), (I-749)+(1.030)+(3.014), (I-749)+(1.030)+(3.015), (I-749)+(1.030)+(3.016), (I-749)+(1.030)+(3.017), (I-749)+(1.030)+(3.018), (I-749)+(1.030)+(3.019), (I-749)+(1.030)+(3.020), (I-749)+(1.030)+(3.021), (I-749)+(1.030)+(3.022), (I-749)+(1.030)+(3.023), (I-749)+(1.030)+(3.024), (I-749)+(1.030)+(3.025), (I-749)+(1.030)+(3.026), (I-749)+(1.030)+(3.027), (I-749)+(1.030)+(3.028), (I-749)+(1.030)+(3.029), (I-749)+(1.030)+(3.030), (I-749)+(1.030)+(3.031), (I-749)+(1.030)+(5.001), (I-749)+(1.030)+(5.002), (I-749)+(1.030)+(5.003), (I-749)+(1.030)+(5.004), (I-749)+(1.030)+(5.005), (I-749)+(1.030)+(5.006), (I-749)+(1.030)+(5.007), (I-749)+(1.030)+(5.008), (I-749)+(1.030)+(5.009), (I-749)+(1.030)+(5.010), (I-749)+(1.030)+(5.011), (I-749)+(1.030)+(5.012), (I-749)+(1.030)+(5.013), (I-749)+(1.030)+(5.014), (I-749)+(1.030)+(5.015), (I-749)+(1.030)+(5.016), (I-749)+(1.030)+(5.017), (I-749)+(1.030)+(5.018), (I-749)+(1.030)+(5.019), (I-749)+(1.030)+(5.020), (I-749)+(1.030)+(5.021), (I-749)+(1.030)+(5.022), (I-749)+(1.030)+(5.023), (I-749)+(1.030)+(6.001), (I-749)+(1.030)+(6.002), (I-749)+(1.030)+(6.003), (I-749)+(1.030)+(6.004), (I-749)+(1.030)+(7.001), (I-749)+(1.030)+(7.002), (I-749)+(1.030)+(7.003), (I-749)+(1.030)+(7.004), (I-749)+(1.030)+(7.005), (I-749)+(1.030)+(7.006), (I-749)+(1.030)+(9.001), (I-749)+(1.030)+(9.002), (I-749)+(1.030)+(9.003), (I-749)+(1.030)+(9.004), (I-749)+(1.030)+(9.005), (I-749)+(1.030)+(9.006), (I-749)+(1.030)+(9.007), (I-749)+(1.030)+(9.008), (I-749)+(1.030)+(9.009), (I-749)+(1.030)+(14.001), (I-749)+(1.030)+(14.002), (I-749)+(1.030)+(15.008), (I-749)+(1.030)+(15.011), (I-749)+(1.030)+(15.012), (I-749)+(1.030)+(15.016), (I-749)+(1.030)+(15.025), (I-749)+(1.030)+(15.027), (I-749)+(1.030)+(15.047), (I-749)+(1.030)+(15.063), (I-749)+(1.030)+(15.064), (I-749)+(1.030)+(16.001), (I-749)+(1.030)+(16.002), (I-749)+(1.030)+(16.003), (I-749)+(1.030)+(16.004), (I-749)+(1.030)+(16.005), (I-749)+(1.030)+(16.006), (I-749)+(1.030)+(16.007), (I-749)+(1.030)+(16.008), (I-749)+(1.030)+(17.001), (I-749)+(1.030)+(17.002), (I-749)+(1.030)+(17.003), (I-749)+(1.030)+(17.004), (I-749)+(1.030)+(17.005), (I-749)+(1.030)+(17.006), (I-749)+(1.030)+(17.007), (I-749)+(1.030)+(17.008), (I-749)+(1.030)+(17.009), (I-749)+(1.030)+(17.010), (I-749)+(1.030)+(17.011), (I-749)+(1.030)+(17.012), (I-749)+(1.030)+(18.001),

(I-749)+(1.031)+(1.032), (I-749)+(1.031)+(1.033), (I-749)+(1.031)+(1.034), (I-749)+(1.031)+(1.035), (I-749)+(1.031)+(1.036), (I-749)+(1.031)+(1.037), (I-749)+(1.031)+(1.038), (I-749)+(1.031)+(1.039), (I-749)+(1.031)+(1.040), (I-749)+(1.031)+(1.041), (I-749)+(1.031)+(1.042), (I-749)+(1.031)+(1.043), (I-749)+(1.031)+(1.044), (I-749)+(1.031)+(1.045), (I-749)+(1.031)+(1.046), (I-749)+(1.031)+(1.047), (I-749)+(1.031)+(1.048), (I-749)+(1.031)+(1.049), (I-749)+(1.031)+(1.050), (I-749)+(1.031)+(1.051), (I-749)+(1.031)+(1.052), (I-749)+(1.031)+(1.053), (I-749)+(1.031)+(1.054), (I-749)+(1.031)+(1.055), (I-749)+(1.031)+(1.056), (I-749)+(1.031)+(1.057), (I-749)+(1.031)+(1.058), (I-749)+(1.031)+(1.059), (I-749)+(1.031)+(1.060), (I-749)+(1.031)+(1.061), (I-749)+(1.031)+(1.062), (I-749)+(1.031)+(1.063), (I-749)+(1.031)+(1.064), (I-749)+(1.031)+(1.065), (I-749)+(1.031)+(1.066), (I-749)+(1.031)+(1.067), (I-749)+(1.031)+(1.068), (I-749)+(1.031)+(1.069), (I-749)+(1.031)+(1.070), (I-749)+(1.031)+(1.071), (I-749)+(1.031)+(1.072), (I-749)+(1.031)+(1.073), (I-749)+(1.031)+(1.074), (I-749)+(1.031)+(1.075), (I-749)+(1.031)+(1.076), (I-749)+(1.031)+(1.077), (I-749)+(1.031)+(1.078), (I-749)+(1.031)+(1.079), (I-749)+(1.031)+(1.080), (I-749)+(1.031)+(1.081), (I-749)+(1.031)+(1.082), (I-749)+(1.031)+(1.083), (I-749)+(1.031)+(1.084), (I-749)+(1.031)+(1.085), (I-749)+(1.031)+(1.086), (I-749)+(1.031)+(1.087), (I-749)+(1.031)+(1.088), (I-749)+(1.031)+(1.089), (I-749)+(1.031)+(1.090), (I-749)+(1.031)+(1.091), (I-749)+(1.031)+(1.092), (I-749)+(1.031)+(2.001), (I-749)+(1.031)+(2.002), (I-749)+(1.031)+(2.003), (I-749)+(1.031)+(2.004), (I-749)+(1.031)+(2.005), (I-749)+(1.031)+(2.006), (I-749)+(1.031)+(2.007), (I-749)+(1.031)+(2.008), (I-749)+(1.031)+(2.009), (I-749)+(1.031)+(2.010), (I-749)+(1.031)+(2.011), (I-749)+(1.031)+(2.012), (I-749)+(1.031)+(2.013), (I-749)+(1.031)+(2.014), (I-749)+(1.031)+(2.015), (I-749)+(1.031)+(2.016), (I-749)+(1.031)+(2.017), (I-749)+(1.031)+(2.018), (I-749)+(1.031)+(2.019), (I-749)+(1.031)+(2.020), (I-749)+(1.031)+(2.021), (I-749)+(1.031)+(2.022), (I-749)+(1.031)+(2.023), (I-749)+(1.031)+(2.024), (I-749)+(1.031)+(2.025), (I-749)+(1.031)+(2.026), (I-749)+(1.031)+(2.027), (I-749)+(1.031)+(2.028), (I-749)+(1.031)+(2.029), (I-749)+(1.031)+(2.030), (I-749)+(1.031)+(2.031), (I-749)+(1.031)+(2.032), (I-749)+(1.031)+(2.033), (I-749)+(1.031)+(2.034), (I-749)+(1.031)+(2.035), (I-749)+(1.031)+(2.036), (I-749)+(1.031)+(2.037), (I-749)+(1.031)+(2.038), (I-749)+(1.031)+(2.039), (I-749)+(1.031)+(2.040), (I-749)+(1.031)+(2.041), (I-749)+(1.031)+(2.042), (I-749)+(1.031)+(2.043), (I-749)+(1.031)+(2.044), (I-749)+(1.031)+(2.045), (I-749)+(1.031)+(2.046), (I-749)+(1.031)+(2.047), (I-749)+(1.031)+(2.048), (I-749)+(1.031)+(2.049), (I-749)+(1.031)+(2.050), (I-749)+(1.031)+(2.051), (I-749)+(1.031)+(2.052), (I-749)+(1.031)+(2.053), (I-749)+(1.031)+(2.054), (I-749)+(1.031)+(2.055), (I-749)+(1.031)+(2.056), (I-749)+(1.031)+(2.057), (I-749)+(1.031)+(2.058), (I-749)+(1.031)+(2.059), (I-749)+(1.031)+(3.001), (I-749)+(1.031)+(3.002), (I-749)+(1.031)+(3.003), (I-749)+(1.031)+(3.004), (I-749)+(1.031)+(3.005), (I-749)+(1.031)+(3.006), (I-749)+(1.031)+(3.007), (I-749)+(1.031)+(3.008), (I-749)+(1.031)+(3.009), (I-749)+(1.031)+(3.010), (I-749)+(1.031)+(3.011), (I-749)+(1.031)+(3.012), (I-749)+(1.031)+(3.013), (I-749)+(1.031)+(3.014), (I-749)+(1.031)+(3.015), (I-749)+(1.031)+(3.016), (I-749)+(1.031)+(3.017), (I-749)+(1.031)+(3.018), (I-749)+(1.031)+(3.019), (I-749)+(1.031)+(3.020), (I-749)+(1.031)+(3.021), (I-749)+(1.031)+(3.022), (I-749)+(1.031)+(3.023), (I-749)+(1.031)+(3.024), (I-749)+(1.031)+(3.025), (I-749)+(1.031)+(3.026), (I-749)+(1.031)+(3.027), (I-749)+(1.031)+(3.028), (I-749)+(1.031)+(3.029), (I-749)+(1.031)+(3.030), (I-749)+(1.031)+(3.031), (I-749)+(1.031)+(5.001), (I-749)+(1.031)+(5.002), (I-749)+(1.031)+(5.003), (I-749)+(1.031)+(5.004), (I-749)+(1.031)+(5.005), (I-749)+(1.031)+(5.006), (I-749)+(1.031)+(5.007), (I-749)+(1.031)+(5.008), (I-749)+(1.031)+(5.009), (I-749)+(1.031)+(5.010), (I-749)+(1.031)+(5.011), (I-749)+(1.031)+(5.012), (I-749)+(1.031)+(5.013), (I-749)+(1.031)+(5.014), (I-749)+(1.031)+(5.015), (I-749)+(1.031)+(5.016), (I-749)+(1.031)+(5.017), (I-749)+(1.031)+(5.018), (I-749)+(1.031)+(5.019), (I-749)+(1.031)+(5.020), (I-749)+(1.031)+(5.021), (I-749)+(1.031)+(5.022), (I-749)+(1.031)+(5.023), (I-749)+(1.031)+(6.001), (I-749)+(1.031)+(6.002), (I-749)+(1.031)+(6.003), (I-749)+(1.031)+(6.004), (I-749)+(1.031)+(7.001), (I-749)+(1.031)+(7.002), (I-749)+(1.031)+(7.003), (I-749)+(1.031)+(7.004), (I-749)+(1.031)+(7.005), (I-749)+(1.031)+(7.006), (I-749)+(1.031)+(9.001), (I-749)+(1.031)+(9.002), (I-749)+(1.031)+(9.003), (I-749)+(1.031)+(9.004), (I-749)+(1.031)+(9.005), (I-749)+(1.031)+(9.006), (I-749)+(1.031)+(9.007), (I-749)+(1.031)+(9.008), (I-749)+(1.031)+(9.009), (I-749)+(1.031)+(14.001), (I-749)+(1.031)+(14.002), (I-749)+(1.031)+(15.008), (I-749)+(1.031)+(15.011), (I-749)+(1.031)+(15.012), (I-749)+(1.031)+(15.016), (I-749)+(1.031)+(15.025), (I-749)+(1.031)+(15.027), (I-749)+(1.031)+(15.047), (I-749)+(1.031)+(15.063), (I-749)+(1.031)+(15.064), (I-749)+(1.031)+(16.001), (I-749)+(1.031)+(16.002), (I-749)+(1.031)+(16.003), (I-749)+(1.031)+(16.004), (I-749)+(1.031)+(16.005), (I-749)+(1.031)+(16.006), (I-749)+(1.031)+(16.007), (I-749)+(1.031)+(16.008), (I-749)+(1.031)+(17.001), (I-749)+(1.031)+(17.002), (I-749)+(1.031)+(17.003), (I-749)+(1.031)+(17.004), (I-749)+(1.031)+(17.005), (I-749)+(1.031)+(17.006), (I-749)+(1.031)+(17.007), (I-749)+(1.031)+(17.008), (I-749)+(1.031)+(17.009), (I-749)+(1.031)+(17.010), (I-749)+(1.031)+(17.011), (I-749)+(1.031)+(17.012), (I-749)+(1.031)+(18.001),

(I-749)+(1.032)+(1.033), (I-749)+(1.032)+(1.034), (I-749)+(1.032)+(1.035), (I-749)+(1.032)+(1.036), (I-749)+(1.032)+(1.037), (I-749)+(1.032)+(1.038), (I-749)+(1.032)+(1.039), (I-749)+(1.032)+(1.040), (I-749)+(1.032)+(1.041), (I-749)+(1.032)+(1.042), (I-749)+(1.032)+(1.043), (I-749)+(1.032)+(1.044), (I-749)+(1.032)+(1.045), (I-749)+(1.032)+(1.046), (I-749)+(1.032)+(1.047), (I-749)+(1.032)+(1.048), (I-749)+(1.032)+(1.049), (I-749)+(1.032)+(1.050), (I-749)+(1.032)+(1.051), (I-749)+(1.032)+(1.052), (I-749)+(1.032)+(1.053), (I-749)+(1.032)+(1.054), (I-749)+(1.032)+(1.055), (I-749)+(1.032)+(1.056), (I-749)+(1.032)+(1.057), (I-749)+(1.032)+(1.058), (I-749)+(1.032)+(1.059), (I-749)+(1.032)+(1.060), (I-749)+(1.032)+(1.061), (I-749)+(1.032)+(1.062), (I-749)+(1.032)+(1.063), (I-749)+(1.032)+(1.064), (I-749)+(1.032)+(1.065), (I-749)+(1.032)+(1.066), (I-749)+(1.032)+(1.067), (I-749)+(1.032)+(1.068), (I-749)+(1.032)+(1.069), (I-749)+(1.032)+(1.070), (I-749)+(1.032)+(1.071), (I-749)+(1.032)+(1.072), (I-749)+(1.032)+(1.073), (I-749)+(1.032)+(1.074), (I-749)+(1.032)+(1.075), (I-749)+(1.032)+(1.076), (I-749)+(1.032)+(1.077), (I-749)+(1.032)+(1.078), (I-749)+(1.032)+(1.079), (I-749)+(1.032)+(1.080), (I-749)+(1.032)+(1.081), (I-749)+(1.032)+(1.082), (I-749)+(1.032)+(1.083), (I-749)+(1.032)+(1.084), (I-749)+(1.032)+(1.085), (I-749)+(1.032)+(1.086), (I-749)+(1.032)+(1.087), (I-749)+(1.032)+(1.088), (I-749)+(1.032)+(1.089), (I-749)+(1.032)+(1.090), (I-749)+(1.032)+(1.091), (I-749)+(1.032)+(1.092), (I-749)+(1.032)+(2.001), (I-749)+(1.032)+(2.002), (I-749)+(1.032)+(2.003), (I-749)+(1.032)+(2.004), (I-749)+(1.032)+(2.005), (I-749)+(1.032)+(2.006), (I-749)+(1.032)+(2.007), (I-749)+(1.032)+(2.008), (I-749)+(1.032)+(2.009), (I-749)+(1.032)+(2.010), (I-749)+(1.032)+(2.011), (I-749)+(1.032)+(2.012), (I-749)+(1.032)+(2.013), (I-749)+(1.032)+(2.014), (I-749)+(1.032)+(2.015), (I-749)+(1.032)+(2.016), (I-749)+(1.032)+(2.017), (I-749)+(1.032)+(2.018), (I-749)+(1.032)+(2.019), (I-749)+(1.032)+(2.020), (I-749)+(1.032)+(2.021), (I-749)+(1.032)+(2.022), (I-749)+(1.032)+(2.023), (I-749)+(1.032)+(2.024), (I-749)+(1.032)+(2.025), (I-749)+(1.032)+(2.026), (I-749)+(1.032)+(2.027), (I-749)+(1.032)+(2.028), (I-749)+(1.032)+(2.029), (I-749)+(1.032)+(2.030), (I-749)+(1.032)+(2.031), (I-749)+(1.032)+(2.032), (I-749)+(1.032)+(2.033), (I-749)+(1.032)+(2.034), (I-749)+(1.032)+(2.035), (I-749)+(1.032)+(2.036), (I-749)+(1.032)+(2.037), (I-749)+(1.032)+(2.038), (I-749)+(1.032)+(2.039), (I-749)+(1.032)+(2.040), (I-749)+(1.032)+(2.041), (I-749)+(1.032)+(2.042), (I-749)+(1.032)+(2.043), (I-749)+(1.032)+(2.044), (I-749)+(1.032)+(2.045), (I-749)+(1.032)+(2.046), (I-749)+(1.032)+(2.047), (I-749)+(1.032)+(2.048), (I-749)+(1.032)+(2.049), (I-749)+(1.032)+(2.050), (I-749)+(1.032)+(2.051), (I-749)+(1.032)+(2.052), (I-749)+(1.032)+(2.053), (I-749)+(1.032)+(2.054), (I-749)+(1.032)+(2.055), (I-749)+(1.032)+(2.056), (I-749)+(1.032)+(2.057), (I-749)+(1.032)+(2.058), (I-749)+(1.032)+(2.059), (I-749)+(1.032)+(3.001), (I-749)+(1.032)+(3.002), (I-749)+(1.032)+(3.003), (I-749)+(1.032)+(3.004), (I-749)+(1.032)+(3.005), (I-749)+(1.032)+(3.006), (I-749)+(1.032)+(3.007), (I-749)+(1.032)+(3.008), (I-749)+(1.032)+(3.009), (I-749)+(1.032)+(3.010), (I-749)+(1.032)+(3.011), (I-749)+(1.032)+(3.012), (I-749)+(1.032)+(3.013), (I-749)+(1.032)+(3.014), (I-749)+(1.032)+(3.015), (I-749)+(1.032)+(3.016), (I-749)+(1.032)+(3.017), (I-749)+(1.032)+(3.018), (I-749)+(1.032)+(3.019), (I-749)+(1.032)+(3.020), (I-749)+(1.032)+(3.021), (I-749)+(1.032)+(3.022), (I-749)+(1.032)+(3.023), (I-749)+(1.032)+(3.024), (I-749)+(1.032)+(3.025), (I-749)+(1.032)+(3.026), (I-749)+(1.032)+(3.027), (I-749)+(1.032)+(3.028), (I-749)+(1.032)+(3.029), (I-749)+(1.032)+(3.030), (I-749)+(1.032)+(3.031), (I-749)+(1.032)+(5.001), (I-749)+(1.032)+(5.002), (I-749)+(1.032)+(5.003), (I-749)+(1.032)+(5.004), (I-749)+(1.032)+(5.005), (I-749)+(1.032)+(5.006), (I-749)+(1.032)+(5.007), (I-749)+(1.032)+(5.008), (I-749)+(1.032)+(5.009), (I-749)+(1.032)+(5.010), (I-749)+(1.032)+(5.011), (I-749)+(1.032)+(5.012), (I-749)+(1.032)+(5.013), (I-749)+(1.032)+(5.014), (I-749)+(1.032)+(5.015), (I-749)+(1.032)+(5.016), (I-749)+(1.032)+(5.017), (I-749)+(1.032)+(5.018), (I-749)+(1.032)+(5.019), (I-749)+(1.032)+(5.020), (I-749)+(1.032)+(5.021), (I-749)+(1.032)+(5.022), (I-749)+(1.032)+(5.023), (I-749)+(1.032)+(6.001), (I-749)+(1.032)+(6.002), (I-749)+(1.032)+(6.003), (I-749)+(1.032)+(6.004), (I-749)+(1.032)+(7.001), (I-749)+(1.032)+(7.002), (I-749)+(1.032)+(7.003), (I-749)+(1.032)+(7.004), (I-749)+(1.032)+(7.005), (I-749)+(1.032)+(7.006), (I-749)+(1.032)+(9.001), (I-749)+(1.032)+(9.002), (I-749)+(1.032)+(9.003), (I-749)+(1.032)+(9.004), (I-749)+(1.032)+(9.005), (I-749)+(1.032)+(9.006), (I-749)+(1.032)+(9.007), (I-749)+(1.032)+(9.008), (I-749)+(1.032)+(9.009), (I-749)+(1.032)+(14.001), (I-749)+(1.032)+(14.002), (I-749)+(1.032)+(15.008), (I-749)+(1.032)+(15.011), (I-749)+(1.032)+(15.012), (I-749)+(1.032)+(15.016), (I-749)+(1.032)+(15.025), (I-749)+(1.032)+(15.027), (I-749)+(1.032)+(15.047), (I-749)+(1.032)+(15.063), (I-749)+(1.032)+(15.064), (I-749)+(1.032)+(16.001), (I-749)+(1.032)+(16.002), (I-749)+(1.032)+(16.003), (I-749)+(1.032)+(16.004), (I-749)+(1.032)+(16.005), (I-749)+(1.032)+(16.006), (I-749)+(1.032)+(16.007), (I-749)+(1.032)+(16.008), (I-749)+(1.032)+(17.001), (I-749)+(1.032)+(17.002), (I-749)+(1.032)+(17.003), (I-749)+(1.032)+(17.004), (I-749)+(1.032)+(17.005), (I-749)+(1.032)+(17.006), (I-749)+(1.032)+(17.007), (I-749)+(1.032)+(17.008), (I-749)+(1.032)+(17.009), (I-749)+(1.032)+(17.010), (I-749)+(1.032)+(17.011), (I-749)+(1.032)+(17.012), (I-749)+(1.032)+(18.001),

(I-749)+(1.033)+(1.034), (I-749)+(1.033)+(1.035), (I-749)+(1.033)+(1.036), (I-749)+(1.033)+(1.037), (I-749)+(1.033)+(1.038), (I-749)+(1.033)+(1.039), (I-749)+(1.033)+(1.040), (I-749)+(1.033)+(1.041), (I-749)+(1.033)+(1.042), (I-749)+(1.033)+(1.043), (I-749)+(1.033)+(1.044), (I-749)+(1.033)+(1.045), (I-749)+(1.033)+(1.046), (I-749)+(1.033)+(1.047), (I-749)+(1.033)+(1.048), (I-749)+(1.033)+(1.049), (I-749)+(1.033)+(1.050), (I-749)+(1.033)+(1.051), (I-749)+(1.033)+(1.052), (I-749)+(1.033)+(1.053), (I-749)+(1.033)+(1.054), (I-749)+(1.033)+(1.055), (I-749)+(1.033)+(1.056), (I-749)+(1.033)+(1.057), (I-749)+(1.033)+(1.058), (I-749)+(1.033)+(1.059), (I-749)+(1.033)+(1.060), (I-749)+(1.033)+(1.061), (I-749)+(1.033)+(1.062), (I-749)+(1.033)+(1.063), (I-749)+(1.033)+(1.064), (I-749)+(1.033)+(1.065), (I-749)+(1.033)+(1.066), (I-749)+(1.033)+(1.067), (I-749)+(1.033)+(1.068), (I-749)+(1.033)+(1.069), (I-749)+(1.033)+(1.070), (I-749)+(1.033)+(1.071), (I-749)+(1.033)+(1.072), (I-749)+(1.033)+(1.073), (I-749)+(1.033)+(1.074), (I-749)+(1.033)+(1.075), (I-749)+(1.033)+(1.076), (I-749)+(1.033)+(1.077), (I-749)+(1.033)+(1.078), (I-749)+(1.033)+(1.079), (I-749)+(1.033)+(1.080), (I-749)+(1.033)+(1.081), (I-749)+(1.033)+(1.082), (I-749)+(1.033)+(1.083), (I-749)+(1.033)+(1.084), (I-749)+(1.033)+(1.085), (I-749)+(1.033)+(1.086), (I-749)+(1.033)+(1.087), (I-749)+(1.033)+(1.088), (I-749)+(1.033)+(1.089), (I-749)+(1.033)+(1.090), (I-749)+(1.033)+(1.091), (I-749)+(1.033)+(1.092), (I-749)+(1.033)+(2.001), (I-749)+(1.033)+(2.002), (I-749)+(1.033)+(2.003), (I-749)+(1.033)+(2.004), (I-749)+(1.033)+(2.005), (I-749)+(1.033)+(2.006), (I-749)+(1.033)+(2.007), (I-749)+(1.033)+(2.008), (I-749)+(1.033)+(2.009), (I-749)+(1.033)+(2.010), (I-749)+(1.033)+(2.011), (I-749)+(1.033)+(2.012), (I-749)+(1.033)+(2.013), (I-749)+(1.033)+(2.014), (I-749)+(1.033)+(2.015), (I-749)+(1.033)+(2.016), (I-749)+(1.033)+(2.017), (I-749)+(1.033)+(2.018), (I-749)+(1.033)+(2.019), (I-749)+(1.033)+(2.020), (I-749)+(1.033)+(2.021), (I-749)+(1.033)+(2.022), (I-749)+(1.033)+(2.023), (I-749)+(1.033)+(2.024), (I-749)+(1.033)+(2.025), (I-749)+(1.033)+(2.026), (I-749)+(1.033)+(2.027), (I-749)+(1.033)+(2.028), (I-749)+(1.033)+(2.029), (I-749)+(1.033)+(2.030), (I-749)+(1.033)+(2.031), (I-749)+(1.033)+(2.032), (I-749)+(1.033)+(2.033), (I-749)+(1.033)+(2.034), (I-749)+(1.033)+(2.035), (I-749)+(1.033)+(2.036), (I-749)+(1.033)+(2.037), (I-749)+(1.033)+(2.038), (I-749)+(1.033)+(2.039), (I-749)+(1.033)+(2.040), (I-749)+(1.033)+(2.041), (I-749)+(1.033)+(2.042), (I-749)+(1.033)+(2.043), (I-749)+(1.033)+(2.044), (I-749)+(1.033)+(2.045), (I-749)+(1.033)+(2.046), (I-749)+(1.033)+(2.047), (I-749)+(1.033)+(2.048), (I-749)+(1.033)+(2.049), (I-749)+(1.033)+(2.050), (I-749)+(1.033)+(2.051), (I-749)+(1.033)+(2.052), (I-749)+(1.033)+(2.053), (I-749)+(1.033)+(2.054), (I-749)+(1.033)+(2.055), (I-749)+(1.033)+(2.056), (I-749)+(1.033)+(2.057), (I-749)+(1.033)+(2.058), (I-749)+(1.033)+(2.059), (I-749)+(1.033)+(3.001), (I-749)+(1.033)+(3.002), (I-749)+(1.033)+(3.003), (I-749)+(1.033)+(3.004), (I-749)+(1.033)+(3.005), (I-749)+(1.033)+(3.006), (I-749)+(1.033)+(3.007), (I-749)+(1.033)+(3.008), (I-749)+(1.033)+(3.009), (I-749)+(1.033)+(3.010), (I-749)+(1.033)+(3.011), (I-749)+(1.033)+(3.012), (I-749)+(1.033)+(3.013), (I-749)+(1.033)+(3.014), (I-749)+(1.033)+(3.015), (I-749)+(1.033)+(3.016), (I-749)+(1.033)+(3.017), (I-749)+(1.033)+(3.018), (I-749)+(1.033)+(3.019), (I-749)+(1.033)+(3.020), (I-749)+(1.033)+(3.021), (I-749)+(1.033)+(3.022), (I-749)+(1.033)+(3.023), (I-749)+(1.033)+(3.024), (I-749)+(1.033)+(3.025), (I-749)+(1.033)+(3.026), (I-749)+(1.033)+(3.027), (I-749)+(1.033)+(3.028), (I-749)+(1.033)+(3.029), (I-749)+(1.033)+(3.030), (I-749)+(1.033)+(3.031), (I-749)+(1.033)+(5.001), (I-749)+(1.033)+(5.002), (I-749)+(1.033)+(5.003), (I-749)+(1.033)+(5.004), (I-749)+(1.033)+(5.005), (I-749)+(1.033)+(5.006), (I-749)+(1.033)+(5.007), (I-749)+(1.033)+(5.008), (I-749)+(1.033)+(5.009), (I-749)+(1.033)+(5.010), (I-749)+(1.033)+(5.011), (I-749)+(1.033)+(5.012), (I-749)+(1.033)+(5.013), (I-749)+(1.033)+(5.014), (I-749)+(1.033)+(5.015), (I-749)+(1.033)+(5.016), (I-749)+(1.033)+(5.017), (I-749)+(1.033)+(5.018), (I-749)+(1.033)+(5.019), (I-749)+(1.033)+(5.020), (I-749)+(1.033)+(5.021), (I-749)+(1.033)+(5.022), (I-749)+(1.033)+(5.023), (I-749)+(1.033)+(6.001), (I-749)+(1.033)+(6.002), (I-749)+(1.033)+(6.003), (I-749)+(1.033)+(6.004), (I-749)+(1.033)+(7.001), (I-749)+(1.033)+(7.002), (I-749)+(1.033)+(7.003), (I-749)+(1.033)+(7.004), (I-749)+(1.033)+(7.005), (I-749)+(1.033)+(7.006), (I-749)+(1.033)+(9.001), (I-749)+(1.033)+(9.002), (I-749)+(1.033)+(9.003), (I-749)+(1.033)+(9.004), (I-749)+(1.033)+(9.005), (I-749)+(1.033)+(9.006), (I-749)+(1.033)+(9.007), (I-749)+(1.033)+(9.008), (I-749)+(1.033)+(9.009), (I-749)+(1.033)+(14.001), (I-749)+(1.033)+(14.002), (I-749)+(1.033)+(15.008), (I-749)+(1.033)+(15.011), (I-749)+(1.033)+(15.012), (I-749)+(1.033)+(15.016), (I-749)+(1.033)+(15.025), (I-749)+(1.033)+(15.027), (I-749)+(1.033)+(15.047), (I-749)+(1.033)+(15.063), (I-749)+(1.033)+(15.064), (I-749)+(1.033)+(16.001), (I-749)+(1.033)+(16.002), (I-749)+(1.033)+(16.003), (I-749)+(1.033)+(16.004), (I-749)+(1.033)+(16.005), (I-749)+(1.033)+(16.006), (I-749)+(1.033)+(16.007), (I-749)+(1.033)+(16.008), (I-749)+(1.033)+(17.001), (I-749)+(1.033)+(17.002), (I-749)+(1.033)+(17.003), (I-749)+(1.033)+(17.004), (I-749)+(1.033)+(17.005), (I-749)+(1.033)+(17.006), (I-749)+(1.033)+(17.007), (I-749)+(1.033)+(17.008), (I-749)+(1.033)+(17.009), (I-749)+(1.033)+(17.010), (I-749)+(1.033)+(17.011), (I-749)+(1.033)+(17.012), (I-749)+(1.033)+(18.001),

(I-749)+(1.034)+(1.035), (I-749)+(1.034)+(1.036), (I-749)+(1.034)+(1.037), (I-749)+(1.034)+(1.038), (I-749)+(1.034)+(1.039), (I-749)+(1.034)+(1.040), (I-749)+(1.034)+(1.041), (I-749)+(1.034)+(1.042), (I-749)+(1.034)+(1.043), (I-749)+(1.034)+(1.044), (I-749)+(1.034)+(1.045), (I-749)+(1.034)+(1.046), (I-749)+(1.034)+(1.047), (I-749)+(1.034)+(1.048), (I-749)+(1.034)+(1.049), (I-749)+(1.034)+(1.050), (I-749)+(1.034)+(1.051), (I-749)+(1.034)+(1.052), (I-749)+(1.034)+(1.053), (I-749)+(1.034)+(1.054), (I-749)+(1.034)+(1.055), (I-749)+(1.034)+(1.056), (I-749)+(1.034)+(1.057), (I-749)+(1.034)+(1.058), (I-749)+(1.034)+(1.059), (I-749)+(1.034)+(1.060), (I-749)+(1.034)+(1.061), (I-749)+(1.034)+(1.062), (I-749)+(1.034)+(1.063), (I-749)+(1.034)+(1.064), (I-749)+(1.034)+(1.065), (I-749)+(1.034)+(1.066), (I-749)+(1.034)+(1.067), (I-749)+(1.034)+(1.068), (I-749)+(1.034)+(1.069), (I-749)+(1.034)+(1.070), (I-749)+(1.034)+(1.071), (I-749)+(1.034)+(1.072), (I-749)+(1.034)+(1.073), (I-749)+(1.034)+(1.074), (I-749)+(1.034)+(1.075), (I-749)+(1.034)+(1.076), (I-749)+(1.034)+(1.077), (I-749)+(1.034)+(1.078), (I-749)+(1.034)+(1.079), (I-749)+(1.034)+(1.080), (I-749)+(1.034)+(1.081), (I-749)+(1.034)+(1.082), (I-749)+(1.034)+(1.083), (I-749)+(1.034)+(1.084), (I-749)+(1.034)+(1.085), (I-749)+(1.034)+(1.086), (I-749)+(1.034)+(1.087), (I-749)+(1.034)+(1.088), (I-749)+(1.034)+(1.089), (I-749)+(1.034)+(1.090), (I-749)+(1.034)+(1.091), (I-749)+(1.034)+(1.092), (I-749)+(1.034)+(2.001), (I-749)+(1.034)+(2.002), (I-749)+(1.034)+(2.003), (I-749)+(1.034)+(2.004), (I-749)+(1.034)+(2.005), (I-749)+(1.034)+(2.006), (I-749)+(1.034)+(2.007), (I-749)+(1.034)+(2.008), (I-749)+(1.034)+(2.009), (I-749)+(1.034)+(2.010), (I-749)+(1.034)+(2.011), (I-749)+(1.034)+(2.012), (I-749)+(1.034)+(2.013), (I-749)+(1.034)+(2.014), (I-749)+(1.034)+(2.015), (I-749)+(1.034)+(2.016), (I-749)+(1.034)+(2.017), (I-749)+(1.034)+(2.018), (I-749)+(1.034)+(2.019), (I-749)+(1.034)+(2.020), (I-749)+(1.034)+(2.021), (I-749)+(1.034)+(2.022), (I-749)+(1.034)+(2.023), (I-749)+(1.034)+(2.024), (I-749)+(1.034)+(2.025), (I-749)+(1.034)+(2.026), (I-749)+(1.034)+(2.027), (I-749)+(1.034)+(2.028), (I-749)+(1.034)+(2.029), (I-749)+(1.034)+(2.030), (I-749)+(1.034)+(2.031), (I-749)+(1.034)+(2.032), (I-749)+(1.034)+(2.033), (I-749)+(1.034)+(2.034), (I-749)+(1.034)+(2.035), (I-749)+(1.034)+(2.036), (I-749)+(1.034)+(2.037), (I-749)+(1.034)+(2.038), (I-749)+(1.034)+(2.039), (I-749)+(1.034)+(2.040), (I-749)+(1.034)+(2.041), (I-749)+(1.034)+(2.042), (I-749)+(1.034)+(2.043), (I-749)+(1.034)+(2.044), (I-749)+(1.034)+(2.045), (I-749)+(1.034)+(2.046), (I-749)+(1.034)+(2.047), (I-749)+(1.034)+(2.048), (I-749)+(1.034)+(2.049), (I-749)+(1.034)+(2.050), (I-749)+(1.034)+(2.051), (I-749)+(1.034)+(2.052), (I-749)+(1.034)+(2.053), (I-749)+(1.034)+(2.054), (I-749)+(1.034)+(2.055), (I-749)+(1.034)+(2.056), (I-749)+(1.034)+(2.057), (I-749)+(1.034)+(2.058), (I-749)+(1.034)+(2.059), (I-749)+(1.034)+(3.001), (I-749)+(1.034)+(3.002), (I-749)+(1.034)+(3.003), (I-749)+(1.034)+(3.004), (I-749)+(1.034)+(3.005), (I-749)+(1.034)+(3.006), (I-749)+(1.034)+(3.007), (I-749)+(1.034)+(3.008), (I-749)+(1.034)+(3.009), (I-749)+(1.034)+(3.010), (I-749)+(1.034)+(3.011), (I-749)+(1.034)+(3.012), (I-749)+(1.034)+(3.013), (I-749)+(1.034)+(3.014), (I-749)+(1.034)+(3.015), (I-749)+(1.034)+(3.016), (I-749)+(1.034)+(3.017), (I-749)+(1.034)+(3.018), (I-749)+(1.034)+(3.019), (I-749)+(1.034)+(3.020), (I-749)+(1.034)+(3.021), (I-749)+(1.034)+(3.022), (I-749)+(1.034)+(3.023), (I-749)+(1.034)+(3.024), (I-749)+(1.034)+(3.025), (I-749)+(1.034)+(3.026), (I-749)+(1.034)+(3.027), (I-749)+(1.034)+(3.028), (I-749)+(1.034)+(3.029), (I-749)+(1.034)+(3.030), (I-749)+(1.034)+(3.031), (I-749)+(1.034)+(5.001), (I-749)+(1.034)+(5.002), (I-749)+(1.034)+(5.003), (I-749)+(1.034)+(5.004), (I-749)+(1.034)+(5.005), (I-749)+(1.034)+(5.006), (I-749)+(1.034)+(5.007), (I-749)+(1.034)+(5.008), (I-749)+(1.034)+(5.009), (I-749)+(1.034)+(5.010), (I-749)+(1.034)+(5.011), (I-749)+(1.034)+(5.012), (I-749)+(1.034)+(5.013), (I-749)+(1.034)+(5.014), (I-749)+(1.034)+(5.015), (I-749)+(1.034)+(5.016), (I-749)+(1.034)+(5.017), (I-749)+(1.034)+(5.018), (I-749)+(1.034)+(5.019), (I-749)+(1.034)+(5.020), (I-749)+(1.034)+(5.021), (I-749)+(1.034)+(5.022), (I-749)+(1.034)+(5.023), (I-749)+(1.034)+(6.001), (I-749)+(1.034)+(6.002), (I-749)+(1.034)+(6.003), (I-749)+(1.034)+(6.004), (I-749)+(1.034)+(7.001), (I-749)+(1.034)+(7.002), (I-749)+(1.034)+(7.003), (I-749)+(1.034)+(7.004), (I-749)+(1.034)+(7.005), (I-749)+(1.034)+(7.006), (I-749)+(1.034)+(9.001), (I-749)+(1.034)+(9.002), (I-749)+(1.034)+(9.003), (I-749)+(1.034)+(9.004), (I-749)+(1.034)+(9.005), (I-749)+(1.034)+(9.006), (I-749)+(1.034)+(9.007), (I-749)+(1.034)+(9.008), (I-749)+(1.034)+(9.009), (I-749)+(1.034)+(14.001), (I-749)+(1.034)+(14.002), (I-749)+(1.034)+(15.008), (I-749)+(1.034)+(15.011), (I-749)+(1.034)+(15.012), (I-749)+(1.034)+(15.016), (I-749)+(1.034)+(15.025), (I-749)+(1.034)+(15.027), (I-749)+(1.034)+(15.047), (I-749)+(1.034)+(15.063), (I-749)+(1.034)+(15.064),

(I-749)+(1.034)+(16.001), (I-749)+(1.034)+(16.002), (I-749)+(1.034)+(16.003), (I-749)+(1.034)+(16.004), (I-749)+(1.034)+(16.005), (I-749)+(1.034)+(16.006), (I-749)+(1.034)+(16.007), (I-749)+(1.034)+(16.008), (I-749)+(1.034)+(17.001), (I-749)+(1.034)+(17.002), (I-749)+(1.034)+(17.003), (I-749)+(1.034)+(17.004), (I-749)+(1.034)+(17.005), (I-749)+(1.034)+(17.006), (I-749)+(1.034)+(17.007), (I-749)+(1.034)+(17.008), (I-749)+(1.034)+(17.009), (I-749)+(1.034)+(17.010), (I-749)+(1.034)+(17.011), (I-749)+(1.034)+(17.012), (I-749)+(1.034)+(18.001),

(I-749)+(1.035)+(1.036), (I-749)+(1.035)+(1.037), (I-749)+(1.035)+(1.038), (I-749)+(1.035)+(1.039), (I-749)+(1.035)+(1.040), (I-749)+(1.035)+(1.041), (I-749)+(1.035)+(1.042), (I-749)+(1.035)+(1.043), (I-749)+(1.035)+(1.044), (I-749)+(1.035)+(1.045), (I-749)+(1.035)+(1.046), (I-749)+(1.035)+(1.047), (I-749)+(1.035)+(1.048), (I-749)+(1.035)+(1.049), (I-749)+(1.035)+(1.050), (I-749)+(1.035)+(1.051), (I-749)+(1.035)+(1.052), (I-749)+(1.035)+(1.053), (I-749)+(1.035)+(1.054), (I-749)+(1.035)+(1.055), (I-749)+(1.035)+(1.056), (I-749)+(1.035)+(1.057), (I-749)+(1.035)+(1.058), (I-749)+(1.035)+(1.059), (I-749)+(1.035)+(1.060), (I-749)+(1.035)+(1.061), (I-749)+(1.035)+(1.062), (I-749)+(1.035)+(1.063), (I-749)+(1.035)+(1.064), (I-749)+(1.035)+(1.065), (I-749)+(1.035)+(1.066), (I-749)+(1.035)+(1.067), (I-749)+(1.035)+(1.068), (I-749)+(1.035)+(1.069), (I-749)+(1.035)+(1.070), (I-749)+(1.035)+(1.071), (I-749)+(1.035)+(1.072), (I-749)+(1.035)+(1.073), (I-749)+(1.035)+(1.074), (I-749)+(1.035)+(1.075), (I-749)+(1.035)+(1.076), (I-749)+(1.035)+(1.077), (I-749)+(1.035)+(1.078), (I-749)+(1.035)+(1.079), (I-749)+(1.035)+(1.080), (I-749)+(1.035)+(1.081), (I-749)+(1.035)+(1.082), (I-749)+(1.035)+(1.083), (I-749)+(1.035)+(1.084), (I-749)+(1.035)+(1.085), (I-749)+(1.035)+(1.086), (I-749)+(1.035)+(1.087), (I-749)+(1.035)+(1.088), (I-749)+(1.035)+(1.089), (I-749)+(1.035)+(1.090), (I-749)+(1.035)+(1.091), (I-749)+(1.035)+(1.092), (I-749)+(1.035)+(2.001), (I-749)+(1.035)+(2.002), (I-749)+(1.035)+(2.003), (I-749)+(1.035)+(2.004), (I-749)+(1.035)+(2.005), (I-749)+(1.035)+(2.006), (I-749)+(1.035)+(2.007), (I-749)+(1.035)+(2.008), (I-749)+(1.035)+(2.009), (I-749)+(1.035)+(2.010), (I-749)+(1.035)+(2.011), (I-749)+(1.035)+(2.012), (I-749)+(1.035)+(2.013), (I-749)+(1.035)+(2.014), (I-749)+(1.035)+(2.015), (I-749)+(1.035)+(2.016), (I-749)+(1.035)+(2.017), (I-749)+(1.035)+(2.018), (I-749)+(1.035)+(2.019), (I-749)+(1.035)+(2.020), (I-749)+(1.035)+(2.021), (I-749)+(1.035)+(2.022), (I-749)+(1.035)+(2.023), (I-749)+(1.035)+(2.024), (I-749)+(1.035)+(2.025), (I-749)+(1.035)+(2.026), (I-749)+(1.035)+(2.027), (I-749)+(1.035)+(2.028), (I-749)+(1.035)+(2.029), (I-749)+(1.035)+(2.030), (I-749)+(1.035)+(2.031), (I-749)+(1.035)+(2.032), (I-749)+(1.035)+(2.033), (I-749)+(1.035)+(2.034), (I-749)+(1.035)+(2.035), (I-749)+(1.035)+(2.036), (I-749)+(1.035)+(2.037), (I-749)+(1.035)+(2.038), (I-749)+(1.035)+(2.039), (I-749)+(1.035)+(2.040), (I-749)+(1.035)+(2.041), (I-749)+(1.035)+(2.042), (I-749)+(1.035)+(2.043), (I-749)+(1.035)+(2.044), (I-749)+(1.035)+(2.045), (I-749)+(1.035)+(2.046), (I-749)+(1.035)+(2.047), (I-749)+(1.035)+(2.048), (I-749)+(1.035)+(2.049), (I-749)+(1.035)+(2.050), (I-749)+(1.035)+(2.051), (I-749)+(1.035)+(2.052), (I-749)+(1.035)+(2.053), (I-749)+(1.035)+(2.054), (I-749)+(1.035)+(2.055), (I-749)+(1.035)+(2.056), (I-749)+(1.035)+(2.057), (I-749)+(1.035)+(2.058), (I-749)+(1.035)+(2.059), (I-749)+(1.035)+(3.001), (I-749)+(1.035)+(3.002), (I-749)+(1.035)+(3.003), (I-749)+(1.035)+(3.004), (I-749)+(1.035)+(3.005), (I-749)+(1.035)+(3.006), (I-749)+(1.035)+(3.007), (I-749)+(1.035)+(3.008), (I-749)+(1.035)+(3.009), (I-749)+(1.035)+(3.010), (I-749)+(1.035)+(3.011), (I-749)+(1.035)+(3.012), (I-749)+(1.035)+(3.013), (I-749)+(1.035)+(3.014), (I-749)+(1.035)+(3.015), (I-749)+(1.035)+(3.016), (I-749)+(1.035)+(3.017), (I-749)+(1.035)+(3.018), (I-749)+(1.035)+(3.019), (I-749)+(1.035)+(3.020), (I-749)+(1.035)+(3.021), (I-749)+(1.035)+(3.022), (I-749)+(1.035)+(3.023), (I-749)+(1.035)+(3.024), (I-749)+(1.035)+(3.025), (I-749)+(1.035)+(3.026), (I-749)+(1.035)+(3.027), (I-749)+(1.035)+(3.028), (I-749)+(1.035)+(3.029), (I-749)+(1.035)+(3.030), (I-749)+(1.035)+(3.031), (I-749)+(1.035)+(5.001), (I-749)+(1.035)+(5.002), (I-749)+(1.035)+(5.003), (I-749)+(1.035)+(5.004), (I-749)+(1.035)+(5.005), (I-749)+(1.035)+(5.006), (I-749)+(1.035)+(5.007), (I-749)+(1.035)+(5.008), (I-749)+(1.035)+(5.009), (I-749)+(1.035)+(5.010), (I-749)+(1.035)+(5.011), (I-749)+(1.035)+(5.012), (I-749)+(1.035)+(5.013), (I-749)+(1.035)+(5.014), (I-749)+(1.035)+(5.015), (I-749)+(1.035)+(5.016), (I-749)+(1.035)+(5.017), (I-749)+(1.035)+(5.018), (I-749)+(1.035)+(5.019), (I-749)+(1.035)+(5.020), (I-749)+(1.035)+(5.021), (I-749)+(1.035)+(5.022), (I-749)+(1.035)+(5.023), (I-749)+(1.035)+(6.001), (I-749)+(1.035)+(6.002), (I-749)+(1.035)+(6.003), (I-749)+(1.035)+(6.004), (I-749)+(1.035)+(7.001), (I-749)+(1.035)+(7.002), (I-749)+(1.035)+(7.003), (I-749)+(1.035)+(7.004), (I-749)+(1.035)+(7.005), (I-749)+(1.035)+(7.006), (I-749)+(1.035)+(9.001), (I-749)+(1.035)+(9.002), (I-749)+(1.035)+(9.003), (I-749)+(1.035)+(9.004), (I-749)+(1.035)+(9.005), (I-749)+(1.035)+(9.006), (I-749)+(1.035)+(9.007), (I-749)+(1.035)+(9.008), (I-749)+(1.035)+(9.009), (I-749)+(1.035)+(14.001), (I-749)+(1.035)+(14.002), (I-749)+(1.035)+(15.008), (I-749)+(1.035)+(15.011), (I-749)+(1.035)+(15.012), (I-749)+(1.035)+(15.016), (I-749)+(1.035)+(15.025), (I-749)+(1.035)+(15.027), (I-749)+(1.035)+(15.047), (I-749)+(1.035)+(15.063), (I-749)+(1.035)+(15.064), (I-749)+(1.035)+(16.001), (I-749)+(1.035)+(16.002), (I-749)+(1.035)+(16.003), (I-749)+(1.035)+(16.004), (I-749)+(1.035)+(16.005), (I-749)+(1.035)+(16.006), (I-749)+(1.035)+(16.007), (I-749)+(1.035)+(16.008), (I-749)+(1.035)+(17.001), (I-749)+(1.035)+(17.002), (I-749)+(1.035)+(17.003), (I-749)+(1.035)+(17.004), (I-749)+(1.035)+(17.005), (I-749)+(1.035)+(17.006), (I-749)+(1.035)+(17.007), (I-749)+(1.035)+(17.008), (I-749)+(1.035)+(17.009), (I-749)+(1.035)+(17.010), (I-749)+(1.035)+(17.011), (I-749)+(1.035)+(17.012), (I-749)+(1.035)+(18.001),

(I-749)+(1.036)+(1.037), (I-749)+(1.036)+(1.038), (I-749)+(1.036)+(1.039), (I-749)+(1.036)+(1.040), (I-749)+(1.036)+(1.041), (I-749)+(1.036)+(1.042), (I-749)+(1.036)+(1.043), (I-749)+(1.036)+(1.044), (I-749)+(1.036)+(1.045), (I-749)+(1.036)+(1.046), (I-749)+(1.036)+(1.047), (I-749)+(1.036)+(1.048), (I-749)+(1.036)+(1.049), (I-749)+(1.036)+(1.050), (I-749)+(1.036)+(1.051), (I-749)+(1.036)+(1.052), (I-749)+(1.036)+(1.053), (I-749)+(1.036)+(1.054), (I-749)+(1.036)+(1.055), (I-749)+(1.036)+(1.056), (I-749)+(1.036)+(1.057), (I-749)+(1.036)+(1.058), (I-749)+(1.036)+(1.059), (I-749)+(1.036)+(1.060), (I-749)+(1.036)+(1.061), (I-749)+(1.036)+(1.062), (I-749)+(1.036)+(1.063), (I-749)+(1.036)+(1.064), (I-749)+(1.036)+(1.065), (I-749)+(1.036)+(1.066), (I-749)+(1.036)+(1.067), (I-749)+(1.036)+(1.068), (I-749)+(1.036)+(1.069), (I-749)+(1.036)+(1.070), (I-749)+(1.036)+(1.071), (I-749)+(1.036)+(1.072), (I-749)+(1.036)+(1.073), (I-749)+(1.036)+(1.074), (I-749)+(1.036)+(1.075), (I-749)+(1.036)+(1.076), (I-749)+(1.036)+(1.077), (I-749)+(1.036)+(1.078), (I-749)+(1.036)+(1.079), (I-749)+(1.036)+(1.080), (I-749)+(1.036)+(1.081), (I-749)+(1.036)+(1.082), (I-749)+(1.036)+(1.083), (I-749)+(1.036)+(1.084), (I-749)+(1.036)+(1.085), (I-749)+(1.036)+(1.086), (I-749)+(1.036)+(1.087), (I-749)+(1.036)+(1.088), (I-749)+(1.036)+(1.089), (I-749)+(1.036)+(1.090), (I-749)+(1.036)+(1.091), (I-749)+(1.036)+(1.092), (I-749)+(1.036)+(2.001), (I-749)+(1.036)+(2.002), (I-749)+(1.036)+(2.003), (I-749)+(1.036)+(2.004), (I-749)+(1.036)+(2.005), (I-749)+(1.036)+(2.006), (I-749)+(1.036)+(2.007), (I-749)+(1.036)+(2.008), (I-749)+(1.036)+(2.009), (I-749)+(1.036)+(2.010), (I-749)+(1.036)+(2.011), (I-749)+(1.036)+(2.012), (I-749)+(1.036)+(2.013), (I-749)+(1.036)+(2.014), (I-749)+(1.036)+(2.015), (I-749)+(1.036)+(2.016), (I-749)+(1.036)+(2.017), (I-749)+(1.036)+(2.018), (I-749)+(1.036)+(2.019), (I-749)+(1.036)+(2.020), (I-749)+(1.036)+(2.021), (I-749)+(1.036)+(2.022), (I-749)+(1.036)+(2.023), (I-749)+(1.036)+(2.024), (I-749)+(1.036)+(2.025), (I-749)+(1.036)+(2.026), (I-749)+(1.036)+(2.027), (I-749)+(1.036)+(2.028), (I-749)+(1.036)+(2.029), (I-749)+(1.036)+(2.030), (I-749)+(1.036)+(2.031), (I-749)+(1.036)+(2.032), (I-749)+(1.036)+(2.033), (I-749)+(1.036)+(2.034), (I-749)+(1.036)+(2.035), (I-749)+(1.036)+(2.036), (I-749)+(1.036)+(2.037), (I-749)+(1.036)+(2.038), (I-749)+(1.036)+(2.039), (I-749)+(1.036)+(2.040), (I-749)+(1.036)+(2.041), (I-749)+(1.036)+(2.042), (I-749)+(1.036)+(2.043), (I-749)+(1.036)+(2.044), (I-749)+(1.036)+(2.045), (I-749)+(1.036)+(2.046), (I-749)+(1.036)+(2.047), (I-749)+(1.036)+(2.048), (I-749)+(1.036)+(2.049), (I-749)+(1.036)+(2.050), (I-749)+(1.036)+(2.051), (I-749)+(1.036)+(2.052), (I-749)+(1.036)+(2.053), (I-749)+(1.036)+(2.054), (I-749)+(1.036)+(2.055), (I-749)+(1.036)+(2.056), (I-749)+(1.036)+(2.057), (I-749)+(1.036)+(2.058), (I-749)+(1.036)+(2.059), (I-749)+(1.036)+(3.001), (I-749)+(1.036)+(3.002), (I-749)+(1.036)+(3.003), (I-749)+(1.036)+(3.004), (I-749)+(1.036)+(3.005), (I-749)+(1.036)+(3.006), (I-749)+(1.036)+(3.007), (I-749)+(1.036)+(3.008), (I-749)+(1.036)+(3.009), (I-749)+(1.036)+(3.010), (I-749)+(1.036)+(3.011), (I-749)+(1.036)+(3.012), (I-749)+(1.036)+(3.013), (I-749)+(1.036)+(3.014), (I-749)+(1.036)+(3.015), (I-749)+(1.036)+(3.016), (I-749)+(1.036)+(3.017), (I-749)+(1.036)+(3.018), (I-749)+(1.036)+(3.019), (I-749)+(1.036)+(3.020), (I-749)+(1.036)+(3.021), (I-749)+(1.036)+(3.022), (I-749)+(1.036)+(3.023), (I-749)+(1.036)+(3.024), (I-749)+(1.036)+(3.025), (I-749)+(1.036)+(3.026), (I-749)+(1.036)+(3.027), (I-749)+(1.036)+(3.028), (I-749)+(1.036)+(3.029), (I-749)+(1.036)+(3.030), (I-749)+(1.036)+(3.031), (I-749)+(1.036)+(5.001), (I-749)+(1.036)+(5.002), (I-749)+(1.036)+(5.003), (I-749)+(1.036)+(5.004), (I-749)+(1.036)+(5.005), (I-749)+(1.036)+(5.006), (I-749)+(1.036)+(5.007), (I-749)+(1.036)+(5.008), (I-749)+(1.036)+(5.009), (I-749)+(1.036)+(5.010), (I-749)+(1.036)+(5.011), (I-749)+(1.036)+(5.012), (I-749)+(1.036)+(5.013), (I-749)+(1.036)+(5.014), (I-749)+(1.036)+(5.015), (I-749)+(1.036)+(5.016), (I-749)+(1.036)+(5.017), (I-749)+(1.036)+(5.018), (I-749)+(1.036)+(5.019), (I-749)+(1.036)+(5.020), (I-749)+(1.036)+(5.021), (I-749)+(1.036)+(5.022), (I-749)+(1.036)+(5.023), (I-749)+(1.036)+(6.001), (I-749)+(1.036)+(6.002), (I-749)+(1.036)+(6.003), (I-749)+(1.036)+(6.004), (I-749)+(1.036)+(7.001), (I-749)+(1.036)+(7.002), (I-749)+(1.036)+(7.003), (I-749)+(1.036)+(7.004), (I-749)+(1.036)+(7.005), (I-749)+(1.036)+(7.006), (I-749)+(1.036)+(9.001), (I-749)+(1.036)+(9.002), (I-749)+(1.036)+(9.003), (I-749)+(1.036)+(9.004), (I-749)+(1.036)+(9.005), (I-749)+(1.036)+(9.006), (I-749)+(1.036)+(9.007), (I-749)+(1.036)+(9.008), (I-749)+(1.036)+(9.009), (I-749)+(1.036)+(14.001), (I-749)+(1.036)+(14.002), (I-749)+(1.036)+(15.008), (I-749)+(1.036)+(15.011), (I-749)+(1.036)+(15.012), (I-749)+(1.036)+(15.016), (I-749)+(1.036)+(15.025), (I-749)+(1.036)+(15.027), (I-749)+(1.036)+(15.047), (I-749)+(1.036)+(15.063), (I-749)+(1.036)+(15.064), (I-749)+(1.036)+(16.001), (I-749)+(1.036)+(16.002), (I-749)+(1.036)+(16.003), (I-749)+(1.036)+(16.004), (I-749)+(1.036)+(16.005), (I-749)+(1.036)+(16.006), (I-749)+(1.036)+(16.007), (I-749)+(1.036)+(16.008), (I-749)+(1.036)+(17.001), (I-749)+(1.036)+(17.002), (I-749)+(1.036)+(17.003), (I-749)+(1.036)+(17.004), (I-749)+(1.036)+(17.005), (I-749)+(1.036)+(17.006), (I-749)+(1.036)+(17.007), (I-749)+(1.036)+(17.008), (I-749)+(1.036)+(17.009), (I-749)+(1.036)+(17.010), (I-749)+(1.036)+(17.011), (I-749)+(1.036)+(17.012), (I-749)+(1.036)+(18.001),

(I-749)+(1.037)+(1.038), (I-749)+(1.037)+(1.039), (I-749)+(1.037)+(1.040), (I-749)+(1.037)+(1.041), (I-749)+(1.037)+(1.042), (I-749)+(1.037)+(1.043), (I-749)+(1.037)+(1.044), (I-749)+(1.037)+(1.045), (I-749)+(1.037)+(1.046), (I-749)+(1.037)+(1.047), (I-749)+(1.037)+(1.048), (I-749)+(1.037)+(1.049), (I-749)+(1.037)+(1.050), (I-749)+(1.037)+(1.051), (I-749)+(1.037)+(1.052), (I-749)+(1.037)+(1.053), (I-749)+(1.037)+(1.054), (I-749)+(1.037)+(1.055), (I-749)+(1.037)+(1.056), (I-749)+(1.037)+(1.057), (I-749)+(1.037)+(1.058), (I-749)+(1.037)+(1.059), (I-749)+(1.037)+(1.060), (I-749)+(1.037)+(1.061), (I-749)+(1.037)+(1.062), (I-749)+(1.037)+(1.063), (I-749)+(1.037)+(1.064), (I-749)+(1.037)+(1.065), (I-749)+(1.037)+(1.066), (I-749)+(1.037)+(1.067), (I-749)+(1.037)+(1.068), (I-749)+(1.037)+(1.069), (I-749)+(1.037)+(1.070), (I-749)+(1.037)+(1.071), (I-749)+(1.037)+(1.072), (I-749)+(1.037)+(1.073), (I-749)+(1.037)+(1.074), (I-749)+(1.037)+(1.075), (I-749)+(1.037)+(1.076), (I-749)+(1.037)+(1.077), (I-749)+(1.037)+(1.078), (I-749)+(1.037)+(1.079), (I-749)+(1.037)+(1.080), (I-749)+(1.037)+(1.081), (I-749)+(1.037)+(1.082), (I-749)+(1.037)+(1.083), (I-749)+(1.037)+(1.084), (I-749)+(1.037)+(1.085), (I-749)+(1.037)+(1.086), (I-749)+(1.037)+(1.087), (I-749)+(1.037)+(1.088), (I-749)+(1.037)+(1.089), (I-749)+(1.037)+(1.090), (I-749)+(1.037)+(1.091), (I-749)+(1.037)+(1.092), (I-749)+(1.037)+(2.001), (I-749)+(1.037)+(2.002), (I-749)+(1.037)+(2.003), (I-749)+(1.037)+(2.004), (I-749)+(1.037)+(2.005), (I-749)+(1.037)+(2.006), (I-749)+(1.037)+(2.007), (I-749)+(1.037)+(2.008), (I-749)+(1.037)+(2.009), (I-749)+(1.037)+(2.010), (I-749)+(1.037)+(2.011), (I-749)+(1.037)+(2.012), (I-749)+(1.037)+(2.013), (I-749)+(1.037)+(2.014), (I-749)+(1.037)+(2.015), (I-749)+(1.037)+(2.016), (I-749)+(1.037)+(2.017), (I-749)+(1.037)+(2.018), (I-749)+(1.037)+(2.019), (I-749)+(1.037)+(2.020), (I-749)+(1.037)+(2.021), (I-749)+(1.037)+(2.022), (I-749)+(1.037)+(2.023), (I-749)+(1.037)+(2.024), (I-749)+(1.037)+(2.025), (I-749)+(1.037)+(2.026), (I-749)+(1.037)+(2.027), (I-749)+(1.037)+(2.028), (I-749)+(1.037)+(2.029), (I-749)+(1.037)+(2.030), (I-749)+(1.037)+(2.031), (I-749)+(1.037)+(2.032), (I-749)+(1.037)+(2.033), (I-749)+(1.037)+(2.034), (I-749)+(1.037)+(2.035), (I-749)+(1.037)+(2.036), (I-749)+(1.037)+(2.037), (I-749)+(1.037)+(2.038), (I-749)+(1.037)+(2.039), (I-749)+(1.037)+(2.040), (I-749)+(1.037)+(2.041), (I-749)+(1.037)+(2.042), (I-749)+(1.037)+(2.043), (I-749)+(1.037)+(2.044), (I-749)+(1.037)+(2.045), (I-749)+(1.037)+(2.046), (I-749)+(1.037)+(2.047), (I-749)+(1.037)+(2.048), (I-749)+(1.037)+(2.049), (I-749)+(1.037)+(2.050), (I-749)+(1.037)+(2.051), (I-749)+(1.037)+(2.052), (I-749)+(1.037)+(2.053), (I-749)+(1.037)+(2.054), (I-749)+(1.037)+(2.055), (I-749)+(1.037)+(2.056), (I-749)+(1.037)+(2.057), (I-749)+(1.037)+(2.058), (I-749)+(1.037)+(2.059), (I-749)+(1.037)+(3.001), (I-749)+(1.037)+(3.002), (I-749)+(1.037)+(3.003), (I-749)+(1.037)+(3.004), (I-749)+(1.037)+(3.005), (I-749)+(1.037)+(3.006), (I-749)+(1.037)+(3.007), (I-749)+(1.037)+(3.008), (I-749)+(1.037)+(3.009), (I-749)+(1.037)+(3.010), (I-749)+(1.037)+(3.011), (I-749)+(1.037)+(3.012), (I-749)+(1.037)+(3.013), (I-749)+(1.037)+(3.014), (I-749)+(1.037)+(3.015), (I-749)+(1.037)+(3.016), (I-749)+(1.037)+(3.017), (I-749)+(1.037)+(3.018), (I-749)+(1.037)+(3.019), (I-749)+(1.037)+(3.020), (I-749)+(1.037)+(3.021), (I-749)+(1.037)+(3.022), (I-749)+(1.037)+(3.023), (I-749)+(1.037)+(3.024), (I-749)+(1.037)+(3.025), (I-749)+(1.037)+(3.026), (I-749)+(1.037)+(3.027), (I-749)+(1.037)+(3.028), (I-749)+(1.037)+(3.029), (I-749)+(1.037)+(3.030), (I-749)+(1.037)+(3.031), (I-749)+(1.037)+(5.001), (I-749)+(1.037)+(5.002), (I-749)+(1.037)+(5.003), (I-749)+(1.037)+(5.004), (I-749)+(1.037)+(5.005), (I-749)+(1.037)+(5.006), (I-749)+(1.037)+(5.007), (I-749)+(1.037)+(5.008), (I-749)+(1.037)+(5.009), (I-749)+(1.037)+(5.010), (I-749)+(1.037)+(5.011), (I-749)+(1.037)+(5.012), (I-749)+(1.037)+(5.013), (I-749)+(1.037)+(5.014), (I-749)+(1.037)+(5.015), (I-749)+(1.037)+(5.016), (I-749)+(1.037)+(5.017), (I-749)+(1.037)+(5.018), (I-749)+(1.037)+(5.019), (I-749)+(1.037)+(5.020), (I-749)+(1.037)+(5.021), (I-749)+(1.037)+(5.022), (I-749)+(1.037)+(5.023), (I-749)+(1.037)+(6.001), (I-749)+(1.037)+(6.002), (I-749)+(1.037)+(6.003), (I-749)+(1.037)+(6.004), (I-749)+(1.037)+(7.001), (I-749)+(1.037)+(7.002), (I-749)+(1.037)+(7.003), (I-749)+(1.037)+(7.004), (I-749)+(1.037)+(7.005), (I-749)+(1.037)+(7.006), (I-749)+(1.037)+(9.001), (I-749)+(1.037)+(9.002), (I-749)+(1.037)+(9.003), (I-749)+(1.037)+(9.004), (I-749)+(1.037)+(9.005), (I-749)+(1.037)+(9.006), (I-749)+(1.037)+(9.007), (I-749)+(1.037)+(9.008), (I-749)+(1.037)+(9.009), (I-749)+(1.037)+(14.001), (I-749)+(1.037)+(14.002), (I-749)+(1.037)+(15.008), (I-749)+(1.037)+(15.011), (I-749)+(1.037)+(15.012), (I-749)+(1.037)+(15.016), (I-749)+(1.037)+(15.025), (I-749)+(1.037)+(15.027), (I-749)+(1.037)+(15.047), (I-749)+(1.037)+(15.063), (I-749)+(1.037)+(15.064), (I-749)+(1.037)+(16.001), (I-749)+(1.037)+(16.002), (I-749)+(1.037)+(16.003), (I-749)+(1.037)+(16.004), (I-749)+(1.037)+(16.005), (I-749)+(1.037)+(16.006), (I-749)+(1.037)+(16.007), (I-749)+(1.037)+(16.008), (I-749)+(1.037)+(17.001), (I-749)+(1.037)+(17.002), (I-749)+(1.037)+(17.003), (I-749)+(1.037)+(17.004), (I-749)+(1.037)+(17.005), (I-749)+(1.037)+(17.006), (I-749)+(1.037)+(17.007), (I-749)+(1.037)+(17.008), (I-749)+(1.037)+(17.009), (I-749)+(1.037)+(17.010), (I-749)+(1.037)+(17.011), (I-749)+(1.037)+(17.012), (I-749)+(1.037)+(18.001),

(I-749)+(1.038)+(1.039), (I-749)+(1.038)+(1.040), (I-749)+(1.038)+(1.041), (I-749)+(1.038)+(1.042), (I-749)+(1.038)+(1.043), (I-749)+(1.038)+(1.044), (I-749)+(1.038)+(1.045), (I-749)+(1.038)+(1.046), (I-749)+(1.038)+(1.047), (I-749)+(1.038)+(1.048), (I-749)+(1.038)+(1.049), (I-749)+(1.038)+(1.050), (I-749)+(1.038)+(1.051), (I-749)+(1.038)+(1.052), (I-749)+(1.038)+(1.053), (I-749)+(1.038)+(1.054), (I-749)+(1.038)+(1.055), (I-749)+(1.038)+(1.056), (I-749)+(1.038)+(1.057), (I-749)+(1.038)+(1.058), (I-749)+(1.038)+(1.059), (I-749)+(1.038)+(1.060), (I-749)+(1.038)+(1.061), (I-749)+(1.038)+(1.062), (I-749)+(1.038)+(1.063), (I-749)+(1.038)+(1.064), (I-749)+(1.038)+(1.065), (I-749)+(1.038)+(1.066), (I-749)+(1.038)+(1.067), (I-749)+(1.038)+(1.068), (I-749)+(1.038)+(1.069), (I-749)+(1.038)+(1.070), (I-749)+(1.038)+(1.071), (I-749)+(1.038)+(1.072), (I-749)+(1.038)+(1.073), (I-749)+(1.038)+(1.074), (I-749)+(1.038)+(1.075), (I-749)+(1.038)+(1.076), (I-749)+(1.038)+(1.077), (I-749)+(1.038)+(1.078), (I-749)+(1.038)+(1.079), (I-749)+(1.038)+(1.080), (I-749)+(1.038)+(1.081), (I-749)+(1.038)+(1.082), (I-749)+(1.038)+(1.083), (I-749)+(1.038)+(1.084), (I-749)+(1.038)+(1.085), (I-749)+(1.038)+(1.086), (I-749)+(1.038)+(1.087), (I-749)+(1.038)+(1.088), (I-749)+(1.038)+(1.089), (I-749)+(1.038)+(1.090), (I-749)+(1.038)+(1.091), (I-749)+(1.038)+(1.092), (I-749)+(1.038)+(2.001), (I-749)+(1.038)+(2.002), (I-749)+(1.038)+(2.003), (I-749)+(1.038)+(2.004), (I-749)+(1.038)+(2.005), (I-749)+(1.038)+(2.006), (I-749)+(1.038)+(2.007), (I-749)+(1.038)+(2.008), (I-749)+(1.038)+(2.009), (I-749)+(1.038)+(2.010), (I-749)+(1.038)+(2.011), (I-749)+(1.038)+(2.012), (I-749)+(1.038)+(2.013), (I-749)+(1.038)+(2.014), (I-749)+(1.038)+(2.015), (I-749)+(1.038)+(2.016), (I-749)+(1.038)+(2.017), (I-749)+(1.038)+(2.018), (I-749)+(1.038)+(2.019), (I-749)+(1.038)+(2.020), (I-749)+(1.038)+(2.021), (I-749)+(1.038)+(2.022), (I-749)+(1.038)+(2.023), (I-749)+(1.038)+(2.024), (I-749)+(1.038)+(2.025), (I-749)+(1.038)+(2.026), (I-749)+(1.038)+(2.027), (I-749)+(1.038)+(2.028), (I-749)+(1.038)+(2.029), (I-749)+(1.038)+(2.030), (I-749)+(1.038)+(2.031), (I-749)+(1.038)+(2.032), (I-749)+(1.038)+(2.033), (I-749)+(1.038)+(2.034), (I-749)+(1.038)+(2.035), (I-749)+(1.038)+(2.036), (I-749)+(1.038)+(2.037), (I-749)+(1.038)+(2.038), (I-749)+(1.038)+(2.039), (I-749)+(1.038)+(2.040), (I-749)+(1.038)+(2.041), (I-749)+(1.038)+(2.042), (I-749)+(1.038)+(2.043), (I-749)+(1.038)+(2.044), (I-749)+(1.038)+(2.045), (I-749)+(1.038)+(2.046), (I-749)+(1.038)+(2.047), (I-749)+(1.038)+(2.048), (I-749)+(1.038)+(2.049), (I-749)+(1.038)+(2.050), (I-749)+(1.038)+(2.051), (I-749)+(1.038)+(2.052), (I-749)+(1.038)+(2.053), (I-749)+(1.038)+(2.054), (I-749)+(1.038)+(2.055), (I-749)+(1.038)+(2.056), (I-749)+(1.038)+(2.057), (I-749)+(1.038)+(2.058), (I-749)+(1.038)+(2.059), (I-749)+(1.038)+(3.001), (I-749)+(1.038)+(3.002), (I-749)+(1.038)+(3.003), (I-749)+(1.038)+(3.004), (I-749)+(1.038)+(3.005), (I-749)+(1.038)+(3.006), (I-749)+(1.038)+(3.007), (I-749)+(1.038)+(3.008), (I-749)+(1.038)+(3.009), (I-749)+(1.038)+(3.010), (I-749)+(1.038)+(3.011), (I-749)+(1.038)+(3.012), (I-749)+(1.038)+(3.013), (I-749)+(1.038)+(3.014), (I-749)+(1.038)+(3.015), (I-749)+(1.038)+(3.016), (I-749)+(1.038)+(3.017), (I-749)+(1.038)+(3.018), (I-749)+(1.038)+(3.019), (I-749)+(1.038)+(3.020), (I-749)+(1.038)+(3.021), (I-749)+(1.038)+(3.022), (I-749)+(1.038)+(3.023), (I-749)+(1.038)+(3.024), (I-749)+(1.038)+(3.025), (I-749)+(1.038)+(3.026), (I-749)+(1.038)+(3.027), (I-749)+(1.038)+(3.028), (I-749)+(1.038)+(3.029), (I-749)+(1.038)+(3.030), (I-749)+(1.038)+(3.031), (I-749)+(1.038)+(5.001), (I-749)+(1.038)+(5.002), (I-749)+(1.038)+(5.003), (I-749)+(1.038)+(5.004), (I-749)+(1.038)+(5.005), (I-749)+(1.038)+(5.006), (I-749)+(1.038)+(5.007), (I-749)+(1.038)+(5.008), (I-749)+(1.038)+(5.009), (I-749)+(1.038)+(5.010), (I-749)+(1.038)+(5.011), (I-749)+(1.038)+(5.012), (I-749)+(1.038)+(5.013), (I-749)+(1.038)+(5.014), (I-749)+(1.038)+(5.015), (I-749)+(1.038)+(5.016), (I-749)+(1.038)+(5.017), (I-749)+(1.038)+(5.018), (I-749)+(1.038)+(5.019), (I-749)+(1.038)+(5.020), (I-749)+(1.038)+(5.021), (I-749)+(1.038)+(5.022), (I-749)+(1.038)+(5.023), (I-749)+(1.038)+(6.001), (I-749)+(1.038)+(6.002), (I-749)+(1.038)+(6.003), (I-749)+(1.038)+(6.004), (I-749)+(1.038)+(7.001), (I-749)+(1.038)+(7.002), (I-749)+(1.038)+(7.003), (I-749)+(1.038)+(7.004), (I-749)+(1.038)+(7.005), (I-749)+(1.038)+(7.006), (I-749)+(1.038)+(9.001), (I-749)+(1.038)+(9.002), (I-749)+(1.038)+(9.003), (I-749)+(1.038)+(9.004), (I-749)+(1.038)+(9.005), (I-749)+(1.038)+(9.006), (I-749)+(1.038)+(9.007), (I-749)+(1.038)+(9.008), (I-749)+(1.038)+(9.009), (I-749)+(1.038)+(14.001), (I-749)+(1.038)+(14.002), (I-749)+(1.038)+(15.008), (I-749)+(1.038)+(15.011), (I-749)+(1.038)+(15.012), (I-749)+(1.038)+(15.016), (I-749)+(1.038)+(15.025), (I-749)+(1.038)+(15.027), (I-749)+(1.038)+(15.047), (I-749)+(1.038)+(15.063), (I-749)+(1.038)+(15.064), (I-749)+(1.038)+(16.001), (I-749)+(1.038)+(16.002), (I-749)+(1.038)+(16.003), (I-749)+(1.038)+(16.004), (I-749)+(1.038)+(16.005), (I-749)+(1.038)+(16.006), (I-749)+(1.038)+(16.007), (I-749)+(1.038)+(16.008), (I-749)+(1.038)+(17.001), (I-749)+(1.038)+(17.002), (I-749)+(1.038)+(17.003), (I-749)+(1.038)+(17.004), (I-749)+(1.038)+(17.005), (I-749)+(1.038)+(17.006), (I-749)+(1.038)+(17.007), (I-749)+(1.038)+(17.008), (I-749)+(1.038)+(17.009), (I-749)+(1.038)+(17.010), (I-749)+(1.038)+(17.011), (I-749)+(1.038)+(17.012), (I-749)+(1.038)+(18.001),

(I-749)+(1.039)+(1.040), (I-749)+(1.039)+(1.041), (I-749)+(1.039)+(1.042), (I-749)+(1.039)+(1.043), (I-749)+(1.039)+(1.044), (I-749)+(1.039)+(1.045), (I-749)+(1.039)+(1.046), (I-749)+(1.039)+(1.047), (I-749)+(1.039)+(1.048), (I-749)+(1.039)+(1.049), (I-749)+(1.039)+(1.050), (I-749)+(1.039)+(1.051), (I-749)+(1.039)+(1.052), (I-749)+(1.039)+(1.053), (I-749)+(1.039)+(1.054), (I-749)+(1.039)+(1.055), (I-749)+(1.039)+(1.056), (I-749)+(1.039)+(1.057), (I-749)+(1.039)+(1.058), (I-749)+(1.039)+(1.059), (I-749)+(1.039)+(1.060), (I-749)+(1.039)+(1.061), (I-749)+(1.039)+(1.062), (I-749)+(1.039)+(1.063), (I-749)+(1.039)+(1.064), (I-749)+(1.039)+(1.065), (I-749)+(1.039)+(1.066), (I-749)+(1.039)+(1.067), (I-749)+(1.039)+(1.068), (I-749)+(1.039)+(1.069), (I-749)+(1.039)+(1.070), (I-749)+(1.039)+(1.071), (I-749)+(1.039)+(1.072), (I-749)+(1.039)+(1.073), (I-749)+(1.039)+(1.074), (I-749)+(1.039)+(1.075), (I-749)+(1.039)+(1.076), (I-749)+(1.039)+(1.077), (I-749)+(1.039)+(1.078), (I-749)+(1.039)+(1.079), (I-749)+(1.039)+(1.080), (I-749)+(1.039)+(1.081), (I-749)+(1.039)+(1.082), (I-749)+(1.039)+(1.083), (I-749)+(1.039)+(1.084), (I-749)+(1.039)+(1.085), (I-749)+(1.039)+(1.086), (I-749)+(1.039)+(1.087), (I-749)+(1.039)+(1.088), (I-749)+(1.039)+(1.089), (I-749)+(1.039)+(1.090), (I-749)+(1.039)+(1.091), (I-749)+(1.039)+(1.092), (I-749)+(1.039)+(2.001), (I-749)+(1.039)+(2.002), (I-749)+(1.039)+(2.003), (I-749)+(1.039)+(2.004), (I-749)+(1.039)+(2.005), (I-749)+(1.039)+(2.006), (I-749)+(1.039)+(2.007), (I-749)+(1.039)+(2.008), (I-749)+(1.039)+(2.009), (I-749)+(1.039)+(2.010), (I-749)+(1.039)+(2.011), (I-749)+(1.039)+(2.012), (I-749)+(1.039)+(2.013), (I-749)+(1.039)+(2.014), (I-749)+(1.039)+(2.015), (I-749)+(1.039)+(2.016), (I-749)+(1.039)+(2.017), (I-749)+(1.039)+(2.018), (I-749)+(1.039)+(2.019), (I-749)+(1.039)+(2.020), (I-749)+(1.039)+(2.021), (I-749)+(1.039)+(2.022), (I-749)+(1.039)+(2.023), (I-749)+(1.039)+(2.024), (I-749)+(1.039)+(2.025), (I-749)+(1.039)+(2.026), (I-749)+(1.039)+(2.027), (I-749)+(1.039)+(2.028), (I-749)+(1.039)+(2.029), (I-749)+(1.039)+(2.030), (I-749)+(1.039)+(2.031), (I-749)+(1.039)+(2.032), (I-749)+(1.039)+(2.033), (I-749)+(1.039)+(2.034), (I-749)+(1.039)+(2.035), (I-749)+(1.039)+(2.036), (I-749)+(1.039)+(2.037), (I-749)+(1.039)+(2.038), (I-749)+(1.039)+(2.039), (I-749)+(1.039)+(2.040), (I-749)+(1.039)+(2.041), (I-749)+(1.039)+(2.042), (I-749)+(1.039)+(2.043), (I-749)+(1.039)+(2.044), (I-749)+(1.039)+(2.045), (I-749)+(1.039)+(2.046), (I-749)+(1.039)+(2.047), (I-749)+(1.039)+(2.048), (I-749)+(1.039)+(2.049), (I-749)+(1.039)+(2.050), (I-749)+(1.039)+(2.051), (I-749)+(1.039)+(2.052), (I-749)+(1.039)+(2.053), (I-749)+(1.039)+(2.054), (I-749)+(1.039)+(2.055), (I-749)+(1.039)+(2.056), (I-749)+(1.039)+(2.057), (I-749)+(1.039)+(2.058), (I-749)+(1.039)+(2.059), (I-749)+(1.039)+(3.001), (I-749)+(1.039)+(3.002), (I-749)+(1.039)+(3.003), (I-749)+(1.039)+(3.004), (I-749)+(1.039)+(3.005), (I-749)+(1.039)+(3.006), (I-749)+(1.039)+(3.007), (I-749)+(1.039)+(3.008), (I-749)+(1.039)+(3.009), (I-749)+(1.039)+(3.010), (I-749)+(1.039)+(3.011), (I-749)+(1.039)+(3.012), (I-749)+(1.039)+(3.013), (I-749)+(1.039)+(3.014), (I-749)+(1.039)+(3.015), (I-749)+(1.039)+(3.016), (I-749)+(1.039)+(3.017), (I-749)+(1.039)+(3.018), (I-749)+(1.039)+(3.019), (I-749)+(1.039)+(3.020), (I-749)+(1.039)+(3.021), (I-749)+(1.039)+(3.022), (I-749)+(1.039)+(3.023), (I-749)+(1.039)+(3.024), (I-749)+(1.039)+(3.025), (I-749)+(1.039)+(3.026), (I-749)+(1.039)+(3.027), (I-749)+(1.039)+(3.028), (I-749)+(1.039)+(3.029), (I-749)+(1.039)+(3.030), (I-749)+(1.039)+(3.031), (I-749)+(1.039)+(5.001), (I-749)+(1.039)+(5.002), (I-749)+(1.039)+(5.003), (I-749)+(1.039)+(5.004), (I-749)+(1.039)+(5.005), (I-749)+(1.039)+(5.006), (I-749)+(1.039)+(5.007), (I-749)+(1.039)+(5.008), (I-749)+(1.039)+(5.009), (I-749)+(1.039)+(5.010), (I-749)+(1.039)+(5.011), (I-749)+(1.039)+(5.012), (I-749)+(1.039)+(5.013), (I-749)+(1.039)+(5.014), (I-749)+(1.039)+(5.015), (I-749)+(1.039)+(5.016), (I-749)+(1.039)+(5.017), (I-749)+(1.039)+(5.018), (I-749)+(1.039)+(5.019), (I-749)+(1.039)+(5.020), (I-749)+(1.039)+(5.021), (I-749)+(1.039)+(5.022), (I-749)+(1.039)+(5.023), (I-749)+(1.039)+(6.001), (I-749)+(1.039)+(6.002), (I-749)+(1.039)+(6.003), (I-749)+(1.039)+(6.004), (I-749)+(1.039)+(7.001), (I-749)+(1.039)+(7.002), (I-749)+(1.039)+(7.003), (I-749)+(1.039)+(7.004), (I-749)+(1.039)+(7.005), (I-749)+(1.039)+(7.006), (I-749)+(1.039)+(9.001), (I-749)+(1.039)+(9.002), (I-749)+(1.039)+(9.003), (I-749)+(1.039)+(9.004), (I-749)+(1.039)+(9.005), (I-749)+(1.039)+(9.006), (I-749)+(1.039)+(9.007), (I-749)+(1.039)+(9.008), (I-749)+(1.039)+(9.009), (I-749)+(1.039)+(14.001), (I-749)+(1.039)+(14.002), (I-749)+(1.039)+(15.008), (I-749)+(1.039)+(15.011), (I-749)+(1.039)+(15.012), (I-749)+(1.039)+(15.016), (I-749)+(1.039)+(15.025), (I-749)+(1.039)+(15.027), (I-749)+(1.039)+(15.047), (I-749)+(1.039)+(15.063), (I-749)+(1.039)+(15.064), (I-749)+(1.039)+(16.001), (I-749)+(1.039)+(16.002), (I-749)+(1.039)+(16.003), (I-749)+(1.039)+(16.004), (I-749)+(1.039)+(16.005), (I-749)+(1.039)+(16.006), (I-749)+(1.039)+(16.007), (I-749)+(1.039)+(16.008), (I-749)+(1.039)+(17.001), (I-749)+(1.039)+(17.002), (I-749)+(1.039)+(17.003), (I-749)+(1.039)+(17.004), (I-749)+(1.039)+(17.005), (I-749)+(1.039)+(17.006), (I-749)+(1.039)+(17.007), (I-749)+(1.039)+(17.008), (I-749)+(1.039)+(17.009), (I-749)+(1.039)+(17.010), (I-749)+(1.039)+(17.011), (I-749)+(1.039)+(17.012), (I-749)+(1.039)+(18.001),

(I-749)+(1.040)+(1.041), (I-749)+(1.040)+(1.042), (I-749)+(1.040)+(1.043), (I-749)+(1.040)+(1.044), (I-749)+(1.040)+(1.045), (I-749)+(1.040)+(1.046), (I-749)+(1.040)+(1.047), (I-749)+(1.040)+(1.048), (I-749)+(1.040)+(1.049), (I-749)+(1.040)+(1.050), (I-749)+(1.040)+(1.051), (I-749)+(1.040)+(1.052), (I-749)+(1.040)+(1.053), (I-749)+(1.040)+(1.054), (I-749)+(1.040)+(1.055), (I-749)+(1.040)+(1.056), (I-749)+(1.040)+(1.057), (I-749)+(1.040)+(1.058), (I-749)+(1.040)+(1.059), (I-749)+(1.040)+(1.060), (I-749)+(1.040)+(1.061), (I-749)+(1.040)+(1.062), (I-749)+(1.040)+(1.063), (I-749)+(1.040)+(1.064), (I-749)+(1.040)+(1.065), (I-749)+(1.040)+(1.066), (I-749)+(1.040)+(1.067), (I-749)+(1.040)+(1.068), (I-749)+(1.040)+(1.069), (I-749)+(1.040)+(1.070), (I-749)+(1.040)+(1.071), (I-749)+(1.040)+(1.072), (I-749)+(1.040)+(1.073), (I-749)+(1.040)+(1.074), (I-749)+(1.040)+(1.075), (I-749)+(1.040)+(1.076), (I-749)+(1.040)+(1.077), (I-749)+(1.040)+(1.078), (I-749)+(1.040)+(1.079), (I-749)+(1.040)+(1.080), (I-749)+(1.040)+(1.081), (I-749)+(1.040)+(1.082), (I-749)+(1.040)+(1.083), (I-749)+(1.040)+(1.084), (I-749)+(1.040)+(1.085), (I-749)+(1.040)+(1.086), (I-749)+(1.040)+(1.087), (I-749)+(1.040)+(1.088), (I-749)+(1.040)+(1.089), (I-749)+(1.040)+(1.090), (I-749)+(1.040)+(1.091), (I-749)+(1.040)+(1.092), (I-749)+(1.040)+(2.001), (I-749)+(1.040)+(2.002), (I-749)+(1.040)+(2.003), (I-749)+(1.040)+(2.004), (I-749)+(1.040)+(2.005), (I-749)+(1.040)+(2.006), (I-749)+(1.040)+(2.007), (I-749)+(1.040)+(2.008), (I-749)+(1.040)+(2.009), (I-749)+(1.040)+(2.010), (I-749)+(1.040)+(2.011), (I-749)+(1.040)+(2.012), (I-749)+(1.040)+(2.013), (I-749)+(1.040)+(2.014), (I-749)+(1.040)+(2.015), (I-749)+(1.040)+(2.016), (I-749)+(1.040)+(2.017), (I-749)+(1.040)+(2.018), (I-749)+(1.040)+(2.019), (I-749)+(1.040)+(2.020), (I-749)+(1.040)+(2.021), (I-749)+(1.040)+(2.022), (I-749)+(1.040)+(2.023), (I-749)+(1.040)+(2.024), (I-749)+(1.040)+(2.025), (I-749)+(1.040)+(2.026), (I-749)+(1.040)+(2.027), (I-749)+(1.040)+(2.028), (I-749)+(1.040)+(2.029), (I-749)+(1.040)+(2.030), (I-749)+(1.040)+(2.031), (I-749)+(1.040)+(2.032), (I-749)+(1.040)+(2.033), (I-749)+(1.040)+(2.034), (I-749)+(1.040)+(2.035), (I-749)+(1.040)+(2.036), (I-749)+(1.040)+(2.037), (I-749)+(1.040)+(2.038), (I-749)+(1.040)+(2.039), (I-749)+(1.040)+(2.040), (I-749)+(1.040)+(2.041), (I-749)+(1.040)+(2.042), (I-749)+(1.040)+(2.043), (I-749)+(1.040)+(2.044), (I-749)+(1.040)+(2.045), (I-749)+(1.040)+(2.046), (I-749)+(1.040)+(2.047), (I-749)+(1.040)+(2.048), (I-749)+(1.040)+(2.049), (I-749)+(1.040)+(2.050), (I-749)+(1.040)+(2.051), (I-749)+(1.040)+(2.052), (I-749)+(1.040)+(2.053), (I-749)+(1.040)+(2.054), (I-749)+(1.040)+(2.055), (I-749)+(1.040)+(2.056), (I-749)+(1.040)+(2.057), (I-749)+(1.040)+(2.058), (I-749)+(1.040)+(2.059), (I-749)+(1.040)+(3.001), (I-749)+(1.040)+(3.002), (I-749)+(1.040)+(3.003), (I-749)+(1.040)+(3.004), (I-749)+(1.040)+(3.005), (I-749)+(1.040)+(3.006), (I-749)+(1.040)+(3.007), (I-749)+(1.040)+(3.008), (I-749)+(1.040)+(3.009), (I-749)+(1.040)+(3.010), (I-749)+(1.040)+(3.011), (I-749)+(1.040)+(3.012), (I-749)+(1.040)+(3.013), (I-749)+(1.040)+(3.014), (I-749)+(1.040)+(3.015), (I-749)+(1.040)+(3.016), (I-749)+(1.040)+(3.017), (I-749)+(1.040)+(3.018), (I-749)+(1.040)+(3.019), (I-749)+(1.040)+(3.020), (I-749)+(1.040)+(3.021), (I-749)+(1.040)+(3.022), (I-749)+(1.040)+(3.023), (I-749)+(1.040)+(3.024), (I-749)+(1.040)+(3.025), (I-749)+(1.040)+(3.026), (I-749)+(1.040)+(3.027), (I-749)+(1.040)+(3.028), (I-749)+(1.040)+(3.029), (I-749)+(1.040)+(3.030), (I-749)+(1.040)+(3.031), (I-749)+(1.040)+(5.001), (I-749)+(1.040)+(5.002), (I-749)+(1.040)+(5.003), (I-749)+(1.040)+(5.004), (I-749)+(1.040)+(5.005), (I-749)+(1.040)+(5.006), (I-749)+(1.040)+(5.007), (I-749)+(1.040)+(5.008), (I-749)+(1.040)+(5.009), (I-749)+(1.040)+(5.010), (I-749)+(1.040)+(5.011), (I-749)+(1.040)+(5.012), (I-749)+(1.040)+(5.013), (I-749)+(1.040)+(5.014), (I-749)+(1.040)+(5.015), (I-749)+(1.040)+(5.016), (I-749)+(1.040)+(5.017), (I-749)+(1.040)+(5.018), (I-749)+(1.040)+(5.019), (I-749)+(1.040)+(5.020), (I-749)+(1.040)+(5.021), (I-749)+(1.040)+(5.022), (I-749)+(1.040)+(5.023), (I-749)+(1.040)+(6.001), (I-749)+(1.040)+(6.002), (I-749)+(1.040)+(6.003), (I-749)+(1.040)+(6.004), (I-749)+(1.040)+(7.001), (I-749)+(1.040)+(7.002), (I-749)+(1.040)+(7.003), (I-749)+(1.040)+(7.004), (I-749)+(1.040)+(7.005), (I-749)+(1.040)+(7.006), (I-749)+(1.040)+(9.001), (I-749)+(1.040)+(9.002), (I-749)+(1.040)+(9.003), (I-749)+(1.040)+(9.004), (I-749)+(1.040)+(9.005), (I-749)+(1.040)+(9.006), (I-749)+(1.040)+(9.007), (I-749)+(1.040)+(9.008), (I-749)+(1.040)+(9.009), (I-749)+(1.040)+(14.001), (I-749)+(1.040)+(14.002), (I-749)+(1.040)+(15.008), (I-749)+(1.040)+(15.011), (I-749)+(1.040)+(15.012), (I-749)+(1.040)+(15.016), (I-749)+(1.040)+(15.025), (I-749)+(1.040)+(15.027), (I-749)+(1.040)+(15.047), (I-749)+(1.040)+(15.063), (I-749)+(1.040)+(15.064), (I-749)+(1.040)+(16.001), (I-749)+(1.040)+(16.002), (I-749)+(1.040)+(16.003), (I-749)+(1.040)+(16.004), (I-749)+(1.040)+(16.005), (I-749)+(1.040)+(16.006), (I-749)+(1.040)+(16.007), (I-749)+(1.040)+(16.008), (I-749)+(1.040)+(17.001), (I-749)+(1.040)+(17.002), (I-749)+(1.040)+(17.003), (I-749)+(1.040)+(17.004), (I-749)+(1.040)+(17.005), (I-749)+(1.040)+(17.006), (I-749)+(1.040)+(17.007), (I-749)+(1.040)+(17.008), (I-749)+(1.040)+(17.009), (I-749)+(1.040)+(17.010), (I-749)+(1.040)+(17.011), (I-749)+(1.040)+(17.012), (I-749)+(1.040)+(18.001),

(I-749)+(1.041)+(1.042), (I-749)+(1.041)+(1.043), (I-749)+(1.041)+(1.044), (I-749)+(1.041)+(1.045), (I-749)+(1.041)+(1.046), (I-749)+(1.041)+(1.047), (I-749)+(1.041)+(1.048), (I-749)+(1.041)+(1.049), (I-749)+(1.041)+(1.050), (I-749)+(1.041)+(1.051), (I-749)+(1.041)+(1.052), (I-749)+(1.041)+(1.053), (I-749)+(1.041)+(1.054), (I-749)+(1.041)+(1.055), (I-749)+(1.041)+(1.056), (I-749)+(1.041)+(1.057), (I-749)+(1.041)+(1.058), (I-749)+(1.041)+(1.059), (I-749)+(1.041)+(1.060), (I-749)+(1.041)+(1.061), (I-749)+(1.041)+(1.062), (I-749)+(1.041)+(1.063), (I-749)+(1.041)+(1.064), (I-749)+(1.041)+(1.065), (I-749)+(1.041)+(1.066), (I-749)+(1.041)+(1.067), (I-749)+(1.041)+(1.068), (I-749)+(1.041)+(1.069), (I-749)+(1.041)+(1.070), (I-749)+(1.041)+(1.071), (I-749)+(1.041)+(1.072), (I-749)+(1.041)+(1.073), (I-749)+(1.041)+(1.074), (I-749)+(1.041)+(1.075), (I-749)+(1.041)+(1.076), (I-749)+(1.041)+(1.077), (I-749)+(1.041)+(1.078), (I-749)+(1.041)+(1.079), (I-749)+(1.041)+(1.080), (I-749)+(1.041)+(1.081), (I-749)+(1.041)+(1.082), (I-749)+(1.041)+(1.083), (I-749)+(1.041)+(1.084), (I-749)+(1.041)+(1.085), (I-749)+(1.041)+(1.086), (I-749)+(1.041)+(1.087), (I-749)+(1.041)+(1.088), (I-749)+(1.041)+(1.089), (I-749)+(1.041)+(1.090), (I-749)+(1.041)+(1.091), (I-749)+(1.041)+(1.092), (I-749)+(1.041)+(2.001), (I-749)+(1.041)+(2.002), (I-749)+(1.041)+(2.003), (I-749)+(1.041)+(2.004), (I-749)+(1.041)+(2.005), (I-749)+(1.041)+(2.006), (I-749)+(1.041)+(2.007), (I-749)+(1.041)+(2.008), (I-749)+(1.041)+(2.009), (I-749)+(1.041)+(2.010), (I-749)+(1.041)+(2.011), (I-749)+(1.041)+(2.012), (I-749)+(1.041)+(2.013), (I-749)+(1.041)+(2.014), (I-749)+(1.041)+(2.015), (I-749)+(1.041)+(2.016), (I-749)+(1.041)+(2.017), (I-749)+(1.041)+(2.018), (I-749)+(1.041)+(2.019), (I-749)+(1.041)+(2.020), (I-749)+(1.041)+(2.021), (I-749)+(1.041)+(2.022), (I-749)+(1.041)+(2.023), (I-749)+(1.041)+(2.024), (I-749)+(1.041)+(2.025), (I-749)+(1.041)+(2.026), (I-749)+(1.041)+(2.027), (I-749)+(1.041)+(2.028), (I-749)+(1.041)+(2.029), (I-749)+(1.041)+(2.030), (I-749)+(1.041)+(2.031), (I-749)+(1.041)+(2.032), (I-749)+(1.041)+(2.033), (I-749)+(1.041)+(2.034), (I-749)+(1.041)+(2.035), (I-749)+(1.041)+(2.036), (I-749)+(1.041)+(2.037), (I-749)+(1.041)+(2.038), (I-749)+(1.041)+(2.039), (I-749)+(1.041)+(2.040), (I-749)+(1.041)+(2.041), (I-749)+(1.041)+(2.042), (I-749)+(1.041)+(2.043), (I-749)+(1.041)+(2.044), (I-749)+(1.041)+(2.045), (I-749)+(1.041)+(2.046), (I-749)+(1.041)+(2.047), (I-749)+(1.041)+(2.048), (I-749)+(1.041)+(2.049), (I-749)+(1.041)+(2.050), (I-749)+(1.041)+(2.051), (I-749)+(1.041)+(2.052), (I-749)+(1.041)+(2.053), (I-749)+(1.041)+(2.054), (I-749)+(1.041)+(2.055), (I-749)+(1.041)+(2.056), (I-749)+(1.041)+(2.057), (I-749)+(1.041)+(2.058), (I-749)+(1.041)+(2.059), (I-749)+(1.041)+(3.001), (I-749)+(1.041)+(3.002), (I-749)+(1.041)+(3.003), (I-749)+(1.041)+(3.004), (I-749)+(1.041)+(3.005), (I-749)+(1.041)+(3.006), (I-749)+(1.041)+(3.007), (I-749)+(1.041)+(3.008), (I-749)+(1.041)+(3.009), (I-749)+(1.041)+(3.010), (I-749)+(1.041)+(3.011), (I-749)+(1.041)+(3.012), (I-749)+(1.041)+(3.013), (I-749)+(1.041)+(3.014), (I-749)+(1.041)+(3.015), (I-749)+(1.041)+(3.016), (I-749)+(1.041)+(3.017), (I-749)+(1.041)+(3.018), (I-749)+(1.041)+(3.019), (I-749)+(1.041)+(3.020), (I-749)+(1.041)+(3.021), (I-749)+(1.041)+(3.022), (I-749)+(1.041)+(3.023), (I-749)+(1.041)+(3.024), (I-749)+(1.041)+(3.025), (I-749)+(1.041)+(3.026), (I-749)+(1.041)+(3.027), (I-749)+(1.041)+(3.028), (I-749)+(1.041)+(3.029), (I-749)+(1.041)+(3.030), (I-749)+(1.041)+(3.031), (I-749)+(1.041)+(5.001), (I-749)+(1.041)+(5.002), (I-749)+(1.041)+(5.003), (I-749)+(1.041)+(5.004), (I-749)+(1.041)+(5.005), (I-749)+(1.041)+(5.006), (I-749)+(1.041)+(5.007), (I-749)+(1.041)+(5.008), (I-749)+(1.041)+(5.009), (I-749)+(1.041)+(5.010), (I-749)+(1.041)+(5.011), (I-749)+(1.041)+(5.012), (I-749)+(1.041)+(5.013), (I-749)+(1.041)+(5.014), (I-749)+(1.041)+(5.015), (I-749)+(1.041)+(5.016), (I-749)+(1.041)+(5.017), (I-749)+(1.041)+(5.018), (I-749)+(1.041)+(5.019), (I-749)+(1.041)+(5.020), (I-749)+(1.041)+(5.021), (I-749)+(1.041)+(5.022), (I-749)+(1.041)+(5.023), (I-749)+(1.041)+(6.001), (I-749)+(1.041)+(6.002), (I-749)+(1.041)+(6.003), (I-749)+(1.041)+(6.004), (I-749)+(1.041)+(7.001), (I-749)+(1.041)+(7.002), (I-749)+(1.041)+(7.003), (I-749)+(1.041)+(7.004), (I-749)+(1.041)+(7.005), (I-749)+(1.041)+(7.006), (I-749)+(1.041)+(9.001), (I-749)+(1.041)+(9.002), (I-749)+(1.041)+(9.003), (I-749)+(1.041)+(9.004), (I-749)+(1.041)+(9.005), (I-749)+(1.041)+(9.006), (I-749)+(1.041)+(9.007), (I-749)+(1.041)+(9.008), (I-749)+(1.041)+(9.009), (I-749)+(1.041)+(14.001), (I-749)+(1.041)+(14.002), (I-749)+(1.041)+(15.008), (I-749)+(1.041)+(15.011), (I-749)+(1.041)+(15.012), (I-749)+(1.041)+(15.016), (I-749)+(1.041)+(15.025), (I-749)+(1.041)+(15.027), (I-749)+(1.041)+(15.047), (I-749)+(1.041)+(15.063), (I-749)+(1.041)+(15.064), (I-749)+(1.041)+(16.001), (I-749)+(1.041)+(16.002), (I-749)+(1.041)+(16.003), (I-749)+(1.041)+(16.004), (I-749)+(1.041)+(16.005), (I-749)+(1.041)+(16.006), (I-749)+(1.041)+(16.007), (I-749)+(1.041)+(16.008), (I-749)+(1.041)+(17.001), (I-749)+(1.041)+(17.002), (I-749)+(1.041)+(17.003), (I-749)+(1.041)+(17.004), (I-749)+(1.041)+(17.005), (I-749)+(1.041)+(17.006), (I-749)+(1.041)+(17.007), (I-749)+(1.041)+(17.008), (I-749)+(1.041)+(17.009), (I-749)+(1.041)+(17.010), (I-749)+(1.041)+(17.011), (I-749)+(1.041)+(17.012), (I-749)+(1.041)+(18.001),

(I-749)+(1.042)+(1.043), (I-749)+(1.042)+(1.044), (I-749)+(1.042)+(1.045), (I-749)+(1.042)+(1.046), (I-749)+(1.042)+(1.047), (I-749)+(1.042)+(1.048), (I-749)+(1.042)+(1.049), (I-749)+(1.042)+(1.050), (I-749)+(1.042)+(1.051), (I-749)+(1.042)+(1.052), (I-749)+(1.042)+(1.053), (I-749)+(1.042)+(1.054), (I-749)+(1.042)+(1.055), (I-749)+(1.042)+(1.056), (I-749)+(1.042)+(1.057), (I-749)+(1.042)+(1.058), (I-749)+(1.042)+(1.059), (I-749)+(1.042)+(1.060), (I-749)+(1.042)+(1.061), (I-749)+(1.042)+(1.062), (I-749)+(1.042)+(1.063), (I-749)+(1.042)+(1.064), (I-749)+(1.042)+(1.065), (I-749)+(1.042)+(1.066), (I-749)+(1.042)+(1.067), (I-749)+(1.042)+(1.068), (I-749)+(1.042)+(1.069), (I-749)+(1.042)+(1.070), (I-749)+(1.042)+(1.071), (I-749)+(1.042)+(1.072), (I-749)+(1.042)+(1.073), (I-749)+(1.042)+(1.074), (I-749)+(1.042)+(1.075), (I-749)+(1.042)+(1.076), (I-749)+(1.042)+(1.077), (I-749)+(1.042)+(1.078), (I-749)+(1.042)+(1.079), (I-749)+(1.042)+(1.080), (I-749)+(1.042)+(1.081), (I-749)+(1.042)+(1.082), (I-749)+(1.042)+(1.083), (I-749)+(1.042)+(1.084), (I-749)+(1.042)+(1.085), (I-749)+(1.042)+(1.086), (I-749)+(1.042)+(1.087), (I-749)+(1.042)+(1.088), (I-749)+(1.042)+(1.089), (I-749)+(1.042)+(1.090), (I-749)+(1.042)+(1.091), (I-749)+(1.042)+(1.092), (I-749)+(1.042)+(2.001), (I-749)+(1.042)+(2.002), (I-749)+(1.042)+(2.003), (I-749)+(1.042)+(2.004), (I-749)+(1.042)+(2.005), (I-749)+(1.042)+(2.006), (I-749)+(1.042)+(2.007), (I-749)+(1.042)+(2.008), (I-749)+(1.042)+(2.009), (I-749)+(1.042)+(2.010), (I-749)+(1.042)+(2.011), (I-749)+(1.042)+(2.012), (I-749)+(1.042)+(2.013), (I-749)+(1.042)+(2.014), (I-749)+(1.042)+(2.015), (I-749)+(1.042)+(2.016), (I-749)+(1.042)+(2.017), (I-749)+(1.042)+(2.018), (I-749)+(1.042)+(2.019), (I-749)+(1.042)+(2.020), (I-749)+(1.042)+(2.021), (I-749)+(1.042)+(2.022), (I-749)+(1.042)+(2.023), (I-749)+(1.042)+(2.024), (I-749)+(1.042)+(2.025), (I-749)+(1.042)+(2.026), (I-749)+(1.042)+(2.027), (I-749)+(1.042)+(2.028), (I-749)+(1.042)+(2.029), (I-749)+(1.042)+(2.030), (I-749)+(1.042)+(2.031), (I-749)+(1.042)+(2.032), (I-749)+(1.042)+(2.033), (I-749)+(1.042)+(2.034), (I-749)+(1.042)+(2.035), (I-749)+(1.042)+(2.036), (I-749)+(1.042)+(2.037), (I-749)+(1.042)+(2.038), (I-749)+(1.042)+(2.039), (I-749)+(1.042)+(2.040), (I-749)+(1.042)+(2.041), (I-749)+(1.042)+(2.042), (I-749)+(1.042)+(2.043), (I-749)+(1.042)+(2.044), (I-749)+(1.042)+(2.045), (I-749)+(1.042)+(2.046), (I-749)+(1.042)+(2.047), (I-749)+(1.042)+(2.048), (I-749)+(1.042)+(2.049), (I-749)+(1.042)+(2.050), (I-749)+(1.042)+(2.051), (I-749)+(1.042)+(2.052), (I-749)+(1.042)+(2.053), (I-749)+(1.042)+(2.054), (I-749)+(1.042)+(2.055), (I-749)+(1.042)+(2.056), (I-749)+(1.042)+(2.057), (I-749)+(1.042)+(2.058), (I-749)+(1.042)+(2.059), (I-749)+(1.042)+(3.001), (I-749)+(1.042)+(3.002), (I-749)+(1.042)+(3.003), (I-749)+(1.042)+(3.004), (I-749)+(1.042)+(3.005), (I-749)+(1.042)+(3.006), (I-749)+(1.042)+(3.007), (I-749)+(1.042)+(3.008), (I-749)+(1.042)+(3.009), (I-749)+(1.042)+(3.010), (I-749)+(1.042)+(3.011), (I-749)+(1.042)+(3.012), (I-749)+(1.042)+(3.013), (I-749)+(1.042)+(3.014), (I-749)+(1.042)+(3.015), (I-749)+(1.042)+(3.016), (I-749)+(1.042)+(3.017), (I-749)+(1.042)+(3.018), (I-749)+(1.042)+(3.019), (I-749)+(1.042)+(3.020), (I-749)+(1.042)+(3.021), (I-749)+(1.042)+(3.022), (I-749)+(1.042)+(3.023), (I-749)+(1.042)+(3.024), (I-749)+(1.042)+(3.025), (I-749)+(1.042)+(3.026), (I-749)+(1.042)+(3.027), (I-749)+(1.042)+(3.028), (I-749)+(1.042)+(3.029), (I-749)+(1.042)+(3.030), (I-749)+(1.042)+(3.031), (I-749)+(1.042)+(5.001), (I-749)+(1.042)+(5.002), (I-749)+(1.042)+(5.003), (I-749)+(1.042)+(5.004), (I-749)+(1.042)+(5.005), (I-749)+(1.042)+(5.006), (I-749)+(1.042)+(5.007), (I-749)+(1.042)+(5.008), (I-749)+(1.042)+(5.009), (I-749)+(1.042)+(5.010), (I-749)+(1.042)+(5.011), (I-749)+(1.042)+(5.012), (I-749)+(1.042)+(5.013), (I-749)+(1.042)+(5.014), (I-749)+(1.042)+(5.015), (I-749)+(1.042)+(5.016), (I-749)+(1.042)+(5.017), (I-749)+(1.042)+(5.018), (I-749)+(1.042)+(5.019), (I-749)+(1.042)+(5.020), (I-749)+(1.042)+(5.021), (I-749)+(1.042)+(5.022), (I-749)+(1.042)+(5.023), (I-749)+(1.042)+(6.001), (I-749)+(1.042)+(6.002), (I-749)+(1.042)+(6.003), (I-749)+(1.042)+(6.004), (I-749)+(1.042)+(7.001), (I-749)+(1.042)+(7.002), (I-749)+(1.042)+(7.003), (I-749)+(1.042)+(7.004), (I-749)+(1.042)+(7.005), (I-749)+(1.042)+(7.006), (I-749)+(1.042)+(9.001), (I-749)+(1.042)+(9.002), (I-749)+(1.042)+(9.003), (I-749)+(1.042)+(9.004), (I-749)+(1.042)+(9.005), (I-749)+(1.042)+(9.006), (I-749)+(1.042)+(9.007), (I-749)+(1.042)+(9.008), (I-749)+(1.042)+(9.009), (I-749)+(1.042)+(14.001), (I-749)+(1.042)+(14.002), (I-749)+(1.042)+(15.008), (I-749)+(1.042)+(15.011), (I-749)+(1.042)+(15.012), (I-749)+(1.042)+(15.016), (I-749)+(1.042)+(15.025), (I-749)+(1.042)+(15.027), (I-749)+(1.042)+(15.047), (I-749)+(1.042)+(15.063), (I-749)+(1.042)+(15.064), (I-749)+(1.042)+(16.001), (I-749)+(1.042)+(16.002), (I-749)+(1.042)+(16.003), (I-749)+(1.042)+(16.004), (I-749)+(1.042)+(16.005), (I-749)+(1.042)+(16.006), (I-749)+(1.042)+(16.007), (I-749)+(1.042)+(16.008), (I-749)+(1.042)+(17.001), (I-749)+(1.042)+(17.002), (I-749)+(1.042)+(17.003), (I-749)+(1.042)+(17.004), (I-749)+(1.042)+(17.005), (I-749)+(1.042)+(17.006), (I-749)+(1.042)+(17.007), (I-749)+(1.042)+(17.008), (I-749)+(1.042)+(17.009), (I-749)+(1.042)+(17.010), (I-749)+(1.042)+(17.011), (I-749)+(1.042)+(17.012), (I-749)+(1.042)+(18.001),

(I-749)+(1.043)+(1.044), (I-749)+(1.043)+(1.045), (I-749)+(1.043)+(1.046), (I-749)+(1.043)+(1.047), (I-749)+(1.043)+(1.048), (I-749)+(1.043)+(1.049), (I-749)+(1.043)+(1.050), (I-749)+(1.043)+(1.051), (I-749)+(1.043)+(1.052), (I-749)+(1.043)+(1.053), (I-749)+(1.043)+(1.054), (I-749)+(1.043)+(1.055), (I-749)+(1.043)+(1.056), (I-749)+(1.043)+(1.057), (I-749)+(1.043)+(1.058), (I-749)+(1.043)+(1.059), (I-749)+(1.043)+(1.060), (I-749)+(1.043)+(1.061), (I-749)+(1.043)+(1.062), (I-749)+(1.043)+(1.063), (I-749)+(1.043)+(1.064), (I-749)+(1.043)+(1.065), (I-749)+(1.043)+(1.066), (I-749)+(1.043)+(1.067), (I-749)+(1.043)+(1.068), (I-749)+(1.043)+(1.069), (I-749)+(1.043)+(1.070), (I-749)+(1.043)+(1.071), (I-749)+(1.043)+(1.072), (I-749)+(1.043)+(1.073), (I-749)+(1.043)+(1.074), (I-749)+(1.043)+(1.075), (I-749)+(1.043)+(1.076), (I-749)+(1.043)+(1.077), (I-749)+(1.043)+(1.078), (I-749)+(1.043)+(1.079), (I-749)+(1.043)+(1.080), (I-749)+(1.043)+(1.081), (I-749)+(1.043)+(1.082), (I-749)+(1.043)+(1.083), (I-749)+(1.043)+(1.084), (I-749)+(1.043)+(1.085), (I-749)+(1.043)+(1.086), (I-749)+(1.043)+(1.087), (I-749)+(1.043)+(1.088), (I-749)+(1.043)+(1.089), (I-749)+(1.043)+(1.090), (I-749)+(1.043)+(1.091), (I-749)+(1.043)+(1.092), (I-749)+(1.043)+(2.001), (I-749)+(1.043)+(2.002), (I-749)+(1.043)+(2.003), (I-749)+(1.043)+(2.004), (I-749)+(1.043)+(2.005), (I-749)+(1.043)+(2.006), (I-749)+(1.043)+(2.007), (I-749)+(1.043)+(2.008), (I-749)+(1.043)+(2.009), (I-749)+(1.043)+(2.010), (I-749)+(1.043)+(2.011), (I-749)+(1.043)+(2.012), (I-749)+(1.043)+(2.013), (I-749)+(1.043)+(2.014), (I-749)+(1.043)+(2.015), (I-749)+(1.043)+(2.016), (I-749)+(1.043)+(2.017), (I-749)+(1.043)+(2.018), (I-749)+(1.043)+(2.019), (I-749)+(1.043)+(2.020), (I-749)+(1.043)+(2.021), (I-749)+(1.043)+(2.022), (I-749)+(1.043)+(2.023), (I-749)+(1.043)+(2.024), (I-749)+(1.043)+(2.025), (I-749)+(1.043)+(2.026), (I-749)+(1.043)+(2.027), (I-749)+(1.043)+(2.028), (I-749)+(1.043)+(2.029), (I-749)+(1.043)+(2.030), (I-749)+(1.043)+(2.031), (I-749)+(1.043)+(2.032), (I-749)+(1.043)+(2.033), (I-749)+(1.043)+(2.034), (I-749)+(1.043)+(2.035), (I-749)+(1.043)+(2.036), (I-749)+(1.043)+(2.037), (I-749)+(1.043)+(2.038), (I-749)+(1.043)+(2.039), (I-749)+(1.043)+(2.040), (I-749)+(1.043)+(2.041), (I-749)+(1.043)+(2.042), (I-749)+(1.043)+(2.043), (I-749)+(1.043)+(2.044), (I-749)+(1.043)+(2.045), (I-749)+(1.043)+(2.046), (I-749)+(1.043)+(2.047), (I-749)+(1.043)+(2.048), (I-749)+(1.043)+(2.049), (I-749)+(1.043)+(2.050), (I-749)+(1.043)+(2.051), (I-749)+(1.043)+(2.052), (I-749)+(1.043)+(2.053), (I-749)+(1.043)+(2.054), (I-749)+(1.043)+(2.055), (I-749)+(1.043)+(2.056), (I-749)+(1.043)+(2.057), (I-749)+(1.043)+(2.058), (I-749)+(1.043)+(2.059), (I-749)+(1.043)+(3.001), (I-749)+(1.043)+(3.002), (I-749)+(1.043)+(3.003), (I-749)+(1.043)+(3.004), (I-749)+(1.043)+(3.005), (I-749)+(1.043)+(3.006), (I-749)+(1.043)+(3.007), (I-749)+(1.043)+(3.008), (I-749)+(1.043)+(3.009), (I-749)+(1.043)+(3.010), (I-749)+(1.043)+(3.011), (I-749)+(1.043)+(3.012), (I-749)+(1.043)+(3.013), (I-749)+(1.043)+(3.014), (I-749)+(1.043)+(3.015), (I-749)+(1.043)+(3.016), (I-749)+(1.043)+(3.017), (I-749)+(1.043)+(3.018), (I-749)+(1.043)+(3.019), (I-749)+(1.043)+(3.020), (I-749)+(1.043)+(3.021), (I-749)+(1.043)+(3.022), (I-749)+(1.043)+(3.023), (I-749)+(1.043)+(3.024), (I-749)+(1.043)+(3.025), (I-749)+(1.043)+(3.026), (I-749)+(1.043)+(3.027), (I-749)+(1.043)+(3.028), (I-749)+(1.043)+(3.029), (I-749)+(1.043)+(3.030), (I-749)+(1.043)+(3.031), (I-749)+(1.043)+(5.001), (I-749)+(1.043)+(5.002), (I-749)+(1.043)+(5.003), (I-749)+(1.043)+(5.004), (I-749)+(1.043)+(5.005), (I-749)+(1.043)+(5.006), (I-749)+(1.043)+(5.007), (I-749)+(1.043)+(5.008), (I-749)+(1.043)+(5.009), (I-749)+(1.043)+(5.010), (I-749)+(1.043)+(5.011), (I-749)+(1.043)+(5.012), (I-749)+(1.043)+(5.013), (I-749)+(1.043)+(5.014), (I-749)+(1.043)+(5.015), (I-749)+(1.043)+(5.016), (I-749)+(1.043)+(5.017), (I-749)+(1.043)+(5.018), (I-749)+(1.043)+(5.019), (I-749)+(1.043)+(5.020), (I-749)+(1.043)+(5.021), (I-749)+(1.043)+(5.022), (I-749)+(1.043)+(5.023), (I-749)+(1.043)+(6.001), (I-749)+(1.043)+(6.002), (I-749)+(1.043)+(6.003), (I-749)+(1.043)+(6.004), (I-749)+(1.043)+(7.001), (I-749)+(1.043)+(7.002), (I-749)+(1.043)+(7.003), (I-749)+(1.043)+(7.004), (I-749)+(1.043)+(7.005), (I-749)+(1.043)+(7.006), (I-749)+(1.043)+(9.001), (I-749)+(1.043)+(9.002), (I-749)+(1.043)+(9.003), (I-749)+(1.043)+(9.004), (I-749)+(1.043)+(9.005), (I-749)+(1.043)+(9.006), (I-749)+(1.043)+(9.007), (I-749)+(1.043)+(9.008), (I-749)+(1.043)+(9.009), (I-749)+(1.043)+(14.001), (I-749)+(1.043)+(14.002), (I-749)+(1.043)+(15.008), (I-749)+(1.043)+(15.011), (I-749)+(1.043)+(15.012), (I-749)+(1.043)+(15.016), (I-749)+(1.043)+(15.025), (I-749)+(1.043)+(15.027), (I-749)+(1.043)+(15.047), (I-749)+(1.043)+(15.063), (I-749)+(1.043)+(15.064), (I-749)+(1.043)+(16.001), (I-749)+(1.043)+(16.002), (I-749)+(1.043)+(16.003), (I-749)+(1.043)+(16.004), (I-749)+(1.043)+(16.005), (I-749)+(1.043)+(16.006), (I-749)+(1.043)+(16.007), (I-749)+(1.043)+(16.008), (I-749)+(1.043)+(17.001), (I-749)+(1.043)+(17.002), (I-749)+(1.043)+(17.003), (I-749)+(1.043)+(17.004), (I-749)+(1.043)+(17.005), (I-749)+(1.043)+(17.006), (I-749)+(1.043)+(17.007), (I-749)+(1.043)+(17.008), (I-749)+(1.043)+(17.009), (I-749)+(1.043)+(17.010), (I-749)+(1.043)+(17.011), (I-749)+(1.043)+(17.012), (I-749)+(1.043)+(18.001),

(I-749)+(1.044)+(1.045), (I-749)+(1.044)+(1.046), (I-749)+(1.044)+(1.047), (I-749)+(1.044)+(1.048), (I-749)+(1.044)+(1.049), (I-749)+(1.044)+(1.050), (I-749)+(1.044)+(1.051), (I-749)+(1.044)+(1.052), (I-749)+(1.044)+(1.053), (I-749)+(1.044)+(1.054), (I-749)+(1.044)+(1.055), (I-749)+(1.044)+(1.056), (I-749)+(1.044)+(1.057), (I-749)+(1.044)+(1.058), (I-749)+(1.044)+(1.059), (I-749)+(1.044)+(1.060), (I-749)+(1.044)+(1.061), (I-749)+(1.044)+(1.062), (I-749)+(1.044)+(1.063), (I-749)+(1.044)+(1.064), (I-749)+(1.044)+(1.065), (I-749)+(1.044)+(1.066), (I-749)+(1.044)+(1.067), (I-749)+(1.044)+(1.068), (I-749)+(1.044)+(1.069), (I-749)+(1.044)+(1.070), (I-749)+(1.044)+(1.071), (I-749)+(1.044)+(1.072), (I-749)+(1.044)+(1.073), (I-749)+(1.044)+(1.074), (I-749)+(1.044)+(1.075), (I-749)+(1.044)+(1.076), (I-749)+(1.044)+(1.077), (I-749)+(1.044)+(1.078), (I-749)+(1.044)+(1.079), (I-749)+(1.044)+(1.080), (I-749)+(1.044)+(1.081), (I-749)+(1.044)+(1.082), (I-749)+(1.044)+(1.083), (I-749)+(1.044)+(1.084), (I-749)+(1.044)+(1.085), (I-749)+(1.044)+(1.086), (I-749)+(1.044)+(1.087), (I-749)+(1.044)+(1.088), (I-749)+(1.044)+(1.089), (I-749)+(1.044)+(1.090), (I-749)+(1.044)+(1.091), (I-749)+(1.044)+(1.092), (I-749)+(1.044)+(2.001), (I-749)+(1.044)+(2.002), (I-749)+(1.044)+(2.003), (I-749)+(1.044)+(2.004), (I-749)+(1.044)+(2.005), (I-749)+(1.044)+(2.006), (I-749)+(1.044)+(2.007), (I-749)+(1.044)+(2.008), (I-749)+(1.044)+(2.009), (I-749)+(1.044)+(2.010), (I-749)+(1.044)+(2.011), (I-749)+(1.044)+(2.012), (I-749)+(1.044)+(2.013), (I-749)+(1.044)+(2.014), (I-749)+(1.044)+(2.015), (I-749)+(1.044)+(2.016), (I-749)+(1.044)+(2.017), (I-749)+(1.044)+(2.018), (I-749)+(1.044)+(2.019), (I-749)+(1.044)+(2.020), (I-749)+(1.044)+(2.021), (I-749)+(1.044)+(2.022), (I-749)+(1.044)+(2.023), (I-749)+(1.044)+(2.024), (I-749)+(1.044)+(2.025), (I-749)+(1.044)+(2.026), (I-749)+(1.044)+(2.027), (I-749)+(1.044)+(2.028), (I-749)+(1.044)+(2.029), (I-749)+(1.044)+(2.030), (I-749)+(1.044)+(2.031), (I-749)+(1.044)+(2.032), (I-749)+(1.044)+(2.033), (I-749)+(1.044)+(2.034), (I-749)+(1.044)+(2.035), (I-749)+(1.044)+(2.036), (I-749)+(1.044)+(2.037), (I-749)+(1.044)+(2.038), (I-749)+(1.044)+(2.039), (I-749)+(1.044)+(2.040), (I-749)+(1.044)+(2.041), (I-749)+(1.044)+(2.042), (I-749)+(1.044)+(2.043), (I-749)+(1.044)+(2.044), (I-749)+(1.044)+(2.045), (I-749)+(1.044)+(2.046), (I-749)+(1.044)+(2.047), (I-749)+(1.044)+(2.048), (I-749)+(1.044)+(2.049), (I-749)+(1.044)+(2.050), (I-749)+(1.044)+(2.051), (I-749)+(1.044)+(2.052), (I-749)+(1.044)+(2.053), (I-749)+(1.044)+(2.054), (I-749)+(1.044)+(2.055), (I-749)+(1.044)+(2.056), (I-749)+(1.044)+(2.057), (I-749)+(1.044)+(2.058), (I-749)+(1.044)+(2.059), (I-749)+(1.044)+(3.001), (I-749)+(1.044)+(3.002), (I-749)+(1.044)+(3.003), (I-749)+(1.044)+(3.004), (I-749)+(1.044)+(3.005), (I-749)+(1.044)+(3.006), (I-749)+(1.044)+(3.007), (I-749)+(1.044)+(3.008), (I-749)+(1.044)+(3.009), (I-749)+(1.044)+(3.010), (I-749)+(1.044)+(3.011), (I-749)+(1.044)+(3.012), (I-749)+(1.044)+(3.013), (I-749)+(1.044)+(3.014), (I-749)+(1.044)+(3.015), (I-749)+(1.044)+(3.016), (I-749)+(1.044)+(3.017), (I-749)+(1.044)+(3.018), (I-749)+(1.044)+(3.019), (I-749)+(1.044)+(3.020), (I-749)+(1.044)+(3.021), (I-749)+(1.044)+(3.022), (I-749)+(1.044)+(3.023), (I-749)+(1.044)+(3.024), (I-749)+(1.044)+(3.025), (I-749)+(1.044)+(3.026), (I-749)+(1.044)+(3.027), (I-749)+(1.044)+(3.028), (I-749)+(1.044)+(3.029), (I-749)+(1.044)+(3.030), (I-749)+(1.044)+(3.031), (I-749)+(1.044)+(5.001), (I-749)+(1.044)+(5.002), (I-749)+(1.044)+(5.003), (I-749)+(1.044)+(5.004), (I-749)+(1.044)+(5.005), (I-749)+(1.044)+(5.006), (I-749)+(1.044)+(5.007), (I-749)+(1.044)+(5.008), (I-749)+(1.044)+(5.009), (I-749)+(1.044)+(5.010), (I-749)+(1.044)+(5.011), (I-749)+(1.044)+(5.012), (I-749)+(1.044)+(5.013), (I-749)+(1.044)+(5.014), (I-749)+(1.044)+(5.015), (I-749)+(1.044)+(5.016), (I-749)+(1.044)+(5.017), (I-749)+(1.044)+(5.018), (I-749)+(1.044)+(5.019), (I-749)+(1.044)+(5.020), (I-749)+(1.044)+(5.021), (I-749)+(1.044)+(5.022), (I-749)+(1.044)+(5.023), (I-749)+(1.044)+(6.001), (I-749)+(1.044)+(6.002), (I-749)+(1.044)+(6.003), (I-749)+(1.044)+(6.004), (I-749)+(1.044)+(7.001), (I-749)+(1.044)+(7.002), (I-749)+(1.044)+(7.003), (I-749)+(1.044)+(7.004), (I-749)+(1.044)+(7.005), (I-749)+(1.044)+(7.006), (I-749)+(1.044)+(9.001), (I-749)+(1.044)+(9.002), (I-749)+(1.044)+(9.003), (I-749)+(1.044)+(9.004), (I-749)+(1.044)+(9.005), (I-749)+(1.044)+(9.006), (I-749)+(1.044)+(9.007), (I-749)+(1.044)+(9.008), (I-749)+(1.044)+(9.009), (I-749)+(1.044)+(14.001), (I-749)+(1.044)+(14.002), (I-749)+(1.044)+(15.008), (I-749)+(1.044)+(15.011), (I-749)+(1.044)+(15.012), (I-749)+(1.044)+(15.016), (I-749)+(1.044)+(15.025), (I-749)+(1.044)+(15.027), (I-749)+(1.044)+(15.047), (I-749)+(1.044)+(15.063), (I-749)+(1.044)+(15.064), (I-749)+(1.044)+(16.001), (I-749)+(1.044)+(16.002), (I-749)+(1.044)+(16.003), (I-749)+(1.044)+(16.004), (I-749)+(1.044)+(16.005), (I-749)+(1.044)+(16.006), (I-749)+(1.044)+(16.007), (I-749)+(1.044)+(16.008), (I-749)+(1.044)+(17.001), (I-749)+(1.044)+(17.002), (I-749)+(1.044)+(17.003), (I-749)+(1.044)+(17.004), (I-749)+(1.044)+(17.005), (I-749)+(1.044)+(17.006), (I-749)+(1.044)+(17.007), (I-749)+(1.044)+(17.008), (I-749)+(1.044)+(17.009), (I-749)+(1.044)+(17.010), (I-749)+(1.044)+(17.011), (I-749)+(1.044)+(17.012), (I-749)+(1.044)+(18.001),

(I-749)+(1.045)+(1.046), (I-749)+(1.045)+(1.047), (I-749)+(1.045)+(1.048), (I-749)+(1.045)+(1.049), (I-749)+(1.045)+(1.050), (I-749)+(1.045)+(1.051), (I-749)+(1.045)+(1.052), (I-749)+(1.045)+(1.053), (I-749)+(1.045)+(1.054), (I-749)+(1.045)+(1.055), (I-749)+(1.045)+(1.056), (I-749)+(1.045)+(1.057), (I-749)+(1.045)+(1.058), (I-749)+(1.045)+(1.059), (I-749)+(1.045)+(1.060), (I-749)+(1.045)+(1.061), (I-749)+(1.045)+(1.062), (I-749)+(1.045)+(1.063), (I-749)+(1.045)+(1.064), (I-749)+(1.045)+(1.065), (I-749)+(1.045)+(1.066), (I-749)+(1.045)+(1.067), (I-749)+(1.045)+(1.068), (I-749)+(1.045)+(1.069), (I-749)+(1.045)+(1.070), (I-749)+(1.045)+(1.071), (I-749)+(1.045)+(1.072), (I-749)+(1.045)+(1.073), (I-749)+(1.045)+(1.074), (I-749)+(1.045)+(1.075), (I-749)+(1.045)+(1.076), (I-749)+(1.045)+(1.077), (I-749)+(1.045)+(1.078), (I-749)+(1.045)+(1.079), (I-749)+(1.045)+(1.080), (I-749)+(1.045)+(1.081), (I-749)+(1.045)+(1.082), (I-749)+(1.045)+(1.083), (I-749)+(1.045)+(1.084), (I-749)+(1.045)+(1.085), (I-749)+(1.045)+(1.086), (I-749)+(1.045)+(1.087), (I-749)+(1.045)+(1.088), (I-749)+(1.045)+(1.089), (I-749)+(1.045)+(1.090), (I-749)+(1.045)+(1.091), (I-749)+(1.045)+(1.092), (I-749)+(1.045)+(2.001), (I-749)+(1.045)+(2.002), (I-749)+(1.045)+(2.003), (I-749)+(1.045)+(2.004), (I-749)+(1.045)+(2.005), (I-749)+(1.045)+(2.006), (I-749)+(1.045)+(2.007), (I-749)+(1.045)+(2.008), (I-749)+(1.045)+(2.009), (I-749)+(1.045)+(2.010), (I-749)+(1.045)+(2.011), (I-749)+(1.045)+(2.012), (I-749)+(1.045)+(2.013), (I-749)+(1.045)+(2.014), (I-749)+(1.045)+(2.015), (I-749)+(1.045)+(2.016), (I-749)+(1.045)+(2.017), (I-749)+(1.045)+(2.018), (I-749)+(1.045)+(2.019), (I-749)+(1.045)+(2.020), (I-749)+(1.045)+(2.021), (I-749)+(1.045)+(2.022), (I-749)+(1.045)+(2.023), (I-749)+(1.045)+(2.024), (I-749)+(1.045)+(2.025), (I-749)+(1.045)+(2.026), (I-749)+(1.045)+(2.027), (I-749)+(1.045)+(2.028), (I-749)+(1.045)+(2.029), (I-749)+(1.045)+(2.030), (I-749)+(1.045)+(2.031), (I-749)+(1.045)+(2.032), (I-749)+(1.045)+(2.033), (I-749)+(1.045)+(2.034), (I-749)+(1.045)+(2.035), (I-749)+(1.045)+(2.036), (I-749)+(1.045)+(2.037), (I-749)+(1.045)+(2.038), (I-749)+(1.045)+(2.039), (I-749)+(1.045)+(2.040), (I-749)+(1.045)+(2.041), (I-749)+(1.045)+(2.042), (I-749)+(1.045)+(2.043), (I-749)+(1.045)+(2.044), (I-749)+(1.045)+(2.045), (I-749)+(1.045)+(2.046), (I-749)+(1.045)+(2.047), (I-749)+(1.045)+(2.048), (I-749)+(1.045)+(2.049), (I-749)+(1.045)+(2.050), (I-749)+(1.045)+(2.051), (I-749)+(1.045)+(2.052), (I-749)+(1.045)+(2.053), (I-749)+(1.045)+(2.054), (I-749)+(1.045)+(2.055), (I-749)+(1.045)+(2.056), (I-749)+(1.045)+(2.057), (I-749)+(1.045)+(2.058), (I-749)+(1.045)+(2.059), (I-749)+(1.045)+(3.001), (I-749)+(1.045)+(3.002), (I-749)+(1.045)+(3.003), (I-749)+(1.045)+(3.004), (I-749)+(1.045)+(3.005), (I-749)+(1.045)+(3.006), (I-749)+(1.045)+(3.007), (I-749)+(1.045)+(3.008), (I-749)+(1.045)+(3.009), (I-749)+(1.045)+(3.010), (I-749)+(1.045)+(3.011), (I-749)+(1.045)+(3.012), (I-749)+(1.045)+(3.013), (I-749)+(1.045)+(3.014), (I-749)+(1.045)+(3.015), (I-749)+(1.045)+(3.016), (I-749)+(1.045)+(3.017), (I-749)+(1.045)+(3.018), (I-749)+(1.045)+(3.019), (I-749)+(1.045)+(3.020), (I-749)+(1.045)+(3.021), (I-749)+(1.045)+(3.022), (I-749)+(1.045)+(3.023), (I-749)+(1.045)+(3.024), (I-749)+(1.045)+(3.025), (I-749)+(1.045)+(3.026), (I-749)+(1.045)+(3.027), (I-749)+(1.045)+(3.028), (I-749)+(1.045)+(3.029), (I-749)+(1.045)+(3.030), (I-749)+(1.045)+(3.031), (I-749)+(1.045)+(5.001), (I-749)+(1.045)+(5.002), (I-749)+(1.045)+(5.003), (I-749)+(1.045)+(5.004), (I-749)+(1.045)+(5.005), (I-749)+(1.045)+(5.006), (I-749)+(1.045)+(5.007), (I-749)+(1.045)+(5.008), (I-749)+(1.045)+(5.009), (I-749)+(1.045)+(5.010), (I-749)+(1.045)+(5.011), (I-749)+(1.045)+(5.012), (I-749)+(1.045)+(5.013), (I-749)+(1.045)+(5.014), (I-749)+(1.045)+(5.015), (I-749)+(1.045)+(5.016), (I-749)+(1.045)+(5.017), (I-749)+(1.045)+(5.018), (I-749)+(1.045)+(5.019), (I-749)+(1.045)+(5.020), (I-749)+(1.045)+(5.021), (I-749)+(1.045)+(5.022), (I-749)+(1.045)+(5.023), (I-749)+(1.045)+(6.001), (I-749)+(1.045)+(6.002), (I-749)+(1.045)+(6.003), (I-749)+(1.045)+(6.004), (I-749)+(1.045)+(7.001), (I-749)+(1.045)+(7.002), (I-749)+(1.045)+(7.003), (I-749)+(1.045)+(7.004), (I-749)+(1.045)+(7.005), (I-749)+(1.045)+(7.006), (I-749)+(1.045)+(9.001), (I-749)+(1.045)+(9.002), (I-749)+(1.045)+(9.003), (I-749)+(1.045)+(9.004), (I-749)+(1.045)+(9.005), (I-749)+(1.045)+(9.006), (I-749)+(1.045)+(9.007), (I-749)+(1.045)+(9.008), (I-749)+(1.045)+(9.009), (I-749)+(1.045)+(14.001), (I-749)+(1.045)+(14.002), (I-749)+(1.045)+(15.008), (I-749)+(1.045)+(15.011), (I-749)+(1.045)+(15.012), (I-749)+(1.045)+(15.016), (I-749)+(1.045)+(15.025), (I-749)+(1.045)+(15.027), (I-749)+(1.045)+(15.047), (I-749)+(1.045)+(15.063), (I-749)+(1.045)+(15.064), (I-749)+(1.045)+(16.001), (I-749)+(1.045)+(16.002), (I-749)+(1.045)+(16.003), (I-749)+(1.045)+(16.004), (I-749)+(1.045)+(16.005), (I-749)+(1.045)+(16.006), (I-749)+(1.045)+(16.007), (I-749)+(1.045)+(16.008), (I-749)+(1.045)+(17.001), (I-749)+(1.045)+(17.002), (I-749)+(1.045)+(17.003), (I-749)+(1.045)+(17.004), (I-749)+(1.045)+(17.005), (I-749)+(1.045)+(17.006), (I-749)+(1.045)+(17.007), (I-749)+(1.045)+(17.008), (I-749)+(1.045)+(17.009), (I-749)+(1.045)+(17.010), (I-749)+(1.045)+(17.011), (I-749)+(1.045)+(17.012), (I-749)+(1.045)+(18.001),

(I-749)+(1.046)+(1.047), (I-749)+(1.046)+(1.048), (I-749)+(1.046)+(1.049), (I-749)+(1.046)+(1.050), (I-749)+(1.046)+(1.051), (I-749)+(1.046)+(1.052), (I-749)+(1.046)+(1.053), (I-749)+(1.046)+(1.054), (I-749)+(1.046)+(1.055), (I-749)+(1.046)+(1.056), (I-749)+(1.046)+(1.057), (I-749)+(1.046)+(1.058), (I-749)+(1.046)+(1.059), (I-749)+(1.046)+(1.060), (I-749)+(1.046)+(1.061), (I-749)+(1.046)+(1.062), (I-749)+(1.046)+(1.063), (I-749)+(1.046)+(1.064), (I-749)+(1.046)+(1.065), (I-749)+(1.046)+(1.066), (I-749)+(1.046)+(1.067), (I-749)+(1.046)+(1.068), (I-749)+(1.046)+(1.069), (I-749)+(1.046)+(1.070), (I-749)+(1.046)+(1.071), (I-749)+(1.046)+(1.072), (I-749)+(1.046)+(1.073), (I-749)+(1.046)+(1.074), (I-749)+(1.046)+(1.075), (I-749)+(1.046)+(1.076), (I-749)+(1.046)+(1.077), (I-749)+(1.046)+(1.078), (I-749)+(1.046)+(1.079), (I-749)+(1.046)+(1.080), (I-749)+(1.046)+(1.081), (I-749)+(1.046)+(1.082), (I-749)+(1.046)+(1.083), (I-749)+(1.046)+(1.084), (I-749)+(1.046)+(1.085), (I-749)+(1.046)+(1.086), (I-749)+(1.046)+(1.087), (I-749)+(1.046)+(1.088), (I-749)+(1.046)+(1.089), (I-749)+(1.046)+(1.090), (I-749)+(1.046)+(1.091), (I-749)+(1.046)+(1.092), (I-749)+(1.046)+(2.001), (I-749)+(1.046)+(2.002), (I-749)+(1.046)+(2.003), (I-749)+(1.046)+(2.004), (I-749)+(1.046)+(2.005), (I-749)+(1.046)+(2.006), (I-749)+(1.046)+(2.007), (I-749)+(1.046)+(2.008), (I-749)+(1.046)+(2.009), (I-749)+(1.046)+(2.010), (I-749)+(1.046)+(2.011), (I-749)+(1.046)+(2.012), (I-749)+(1.046)+(2.013), (I-749)+(1.046)+(2.014), (I-749)+(1.046)+(2.015), (I-749)+(1.046)+(2.016), (I-749)+(1.046)+(2.017), (I-749)+(1.046)+(2.018), (I-749)+(1.046)+(2.019), (I-749)+(1.046)+(2.020), (I-749)+(1.046)+(2.021), (I-749)+(1.046)+(2.022), (I-749)+(1.046)+(2.023), (I-749)+(1.046)+(2.024), (I-749)+(1.046)+(2.025), (I-749)+(1.046)+(2.026), (I-749)+(1.046)+(2.027), (I-749)+(1.046)+(2.028), (I-749)+(1.046)+(2.029), (I-749)+(1.046)+(2.030), (I-749)+(1.046)+(2.031), (I-749)+(1.046)+(2.032), (I-749)+(1.046)+(2.033), (I-749)+(1.046)+(2.034), (I-749)+(1.046)+(2.035), (I-749)+(1.046)+(2.036), (I-749)+(1.046)+(2.037), (I-749)+(1.046)+(2.038), (I-749)+(1.046)+(2.039), (I-749)+(1.046)+(2.040), (I-749)+(1.046)+(2.041), (I-749)+(1.046)+(2.042), (I-749)+(1.046)+(2.043), (I-749)+(1.046)+(2.044), (I-749)+(1.046)+(2.045), (I-749)+(1.046)+(2.046), (I-749)+(1.046)+(2.047), (I-749)+(1.046)+(2.048), (I-749)+(1.046)+(2.049), (I-749)+(1.046)+(2.050), (I-749)+(1.046)+(2.051), (I-749)+(1.046)+(2.052), (I-749)+(1.046)+(2.053), (I-749)+(1.046)+(2.054), (I-749)+(1.046)+(2.055), (I-749)+(1.046)+(2.056), (I-749)+(1.046)+(2.057), (I-749)+(1.046)+(2.058), (I-749)+(1.046)+(2.059), (I-749)+(1.046)+(3.001), (I-749)+(1.046)+(3.002), (I-749)+(1.046)+(3.003), (I-749)+(1.046)+(3.004), (I-749)+(1.046)+(3.005), (I-749)+(1.046)+(3.006), (I-749)+(1.046)+(3.007), (I-749)+(1.046)+(3.008), (I-749)+(1.046)+(3.009), (I-749)+(1.046)+(3.010), (I-749)+(1.046)+(3.011), (I-749)+(1.046)+(3.012), (I-749)+(1.046)+(3.013), (I-749)+(1.046)+(3.014), (I-749)+(1.046)+(3.015), (I-749)+(1.046)+(3.016), (I-749)+(1.046)+(3.017), (I-749)+(1.046)+(3.018), (I-749)+(1.046)+(3.019), (I-749)+(1.046)+(3.020), (I-749)+(1.046)+(3.021), (I-749)+(1.046)+(3.022), (I-749)+(1.046)+(3.023), (I-749)+(1.046)+(3.024), (I-749)+(1.046)+(3.025), (I-749)+(1.046)+(3.026), (I-749)+(1.046)+(3.027), (I-749)+(1.046)+(3.028), (I-749)+(1.046)+(3.029), (I-749)+(1.046)+(3.030), (I-749)+(1.046)+(3.031), (I-749)+(1.046)+(5.001), (I-749)+(1.046)+(5.002), (I-749)+(1.046)+(5.003), (I-749)+(1.046)+(5.004), (I-749)+(1.046)+(5.005), (I-749)+(1.046)+(5.006), (I-749)+(1.046)+(5.007), (I-749)+(1.046)+(5.008), (I-749)+(1.046)+(5.009), (I-749)+(1.046)+(5.010), (I-749)+(1.046)+(5.011), (I-749)+(1.046)+(5.012), (I-749)+(1.046)+(5.013), (I-749)+(1.046)+(5.014), (I-749)+(1.046)+(5.015), (I-749)+(1.046)+(5.016), (I-749)+(1.046)+(5.017), (I-749)+(1.046)+(5.018), (I-749)+(1.046)+(5.019), (I-749)+(1.046)+(5.020), (I-749)+(1.046)+(5.021), (I-749)+(1.046)+(5.022), (I-749)+(1.046)+(5.023), (I-749)+(1.046)+(6.001), (I-749)+(1.046)+(6.002), (I-749)+(1.046)+(6.003), (I-749)+(1.046)+(6.004), (I-749)+(1.046)+(7.001), (I-749)+(1.046)+(7.002), (I-749)+(1.046)+(7.003), (I-749)+(1.046)+(7.004), (I-749)+(1.046)+(7.005), (I-749)+(1.046)+(7.006), (I-749)+(1.046)+(9.001), (I-749)+(1.046)+(9.002), (I-749)+(1.046)+(9.003), (I-749)+(1.046)+(9.004), (I-749)+(1.046)+(9.005), (I-749)+(1.046)+(9.006), (I-749)+(1.046)+(9.007), (I-749)+(1.046)+(9.008), (I-749)+(1.046)+(9.009), (I-749)+(1.046)+(14.001), (I-749)+(1.046)+(14.002), (I-749)+(1.046)+(15.008), (I-749)+(1.046)+(15.011), (I-749)+(1.046)+(15.012), (I-749)+(1.046)+(15.016), (I-749)+(1.046)+(15.025), (I-749)+(1.046)+(15.027), (I-749)+(1.046)+(15.047), (I-749)+(1.046)+(15.063), (I-749)+(1.046)+(15.064), (I-749)+(1.046)+(16.001), (I-749)+(1.046)+(16.002), (I-749)+(1.046)+(16.003), (I-749)+(1.046)+(16.004), (I-749)+(1.046)+(16.005), (I-749)+(1.046)+(16.006), (I-749)+(1.046)+(16.007), (I-749)+(1.046)+(16.008), (I-749)+(1.046)+(17.001), (I-749)+(1.046)+(17.002), (I-749)+(1.046)+(17.003), (I-749)+(1.046)+(17.004), (I-749)+(1.046)+(17.005), (I-749)+(1.046)+(17.006), (I-749)+(1.046)+(17.007), (I-749)+(1.046)+(17.008), (I-749)+(1.046)+(17.009), (I-749)+(1.046)+(17.010), (I-749)+(1.046)+(17.011), (I-749)+(1.046)+(17.012), (I-749)+(1.046)+(18.001),

(I-749)+(1.047)+(1.048), (I-749)+(1.047)+(1.049), (I-749)+(1.047)+(1.050), (I-749)+(1.047)+(1.051), (I-749)+(1.047)+(1.052), (I-749)+(1.047)+(1.053), (I-749)+(1.047)+(1.054), (I-749)+(1.047)+(1.055), (I-749)+(1.047)+(1.056), (I-749)+(1.047)+(1.057), (I-749)+(1.047)+(1.058), (I-749)+(1.047)+(1.059), (I-749)+(1.047)+(1.060), (I-749)+(1.047)+(1.061), (I-749)+(1.047)+(1.062), (I-749)+(1.047)+(1.063), (I-749)+(1.047)+(1.064), (I-749)+(1.047)+(1.065), (I-749)+(1.047)+(1.066), (I-749)+(1.047)+(1.067), (I-749)+(1.047)+(1.068), (I-749)+(1.047)+(1.069), (I-749)+(1.047)+(1.070), (I-749)+(1.047)+(1.071), (I-749)+(1.047)+(1.072), (I-749)+(1.047)+(1.073), (I-749)+(1.047)+(1.074), (I-749)+(1.047)+(1.075), (I-749)+(1.047)+(1.076), (I-749)+(1.047)+(1.077), (I-749)+(1.047)+(1.078), (I-749)+(1.047)+(1.079), (I-749)+(1.047)+(1.080), (I-749)+(1.047)+(1.081), (I-749)+(1.047)+(1.082), (I-749)+(1.047)+(1.083), (I-749)+(1.047)+(1.084), (I-749)+(1.047)+(1.085), (I-749)+(1.047)+(1.086), (I-749)+(1.047)+(1.087), (I-749)+(1.047)+(1.088), (I-749)+(1.047)+(1.089), (I-749)+(1.047)+(1.090), (I-749)+(1.047)+(1.091), (I-749)+(1.047)+(1.092), (I-749)+(1.047)+(2.001), (I-749)+(1.047)+(2.002), (I-749)+(1.047)+(2.003), (I-749)+(1.047)+(2.004), (I-749)+(1.047)+(2.005), (I-749)+(1.047)+(2.006), (I-749)+(1.047)+(2.007), (I-749)+(1.047)+(2.008), (I-749)+(1.047)+(2.009), (I-749)+(1.047)+(2.010), (I-749)+(1.047)+(2.011), (I-749)+(1.047)+(2.012), (I-749)+(1.047)+(2.013), (I-749)+(1.047)+(2.014), (I-749)+(1.047)+(2.015), (I-749)+(1.047)+(2.016), (I-749)+(1.047)+(2.017), (I-749)+(1.047)+(2.018), (I-749)+(1.047)+(2.019), (I-749)+(1.047)+(2.020), (I-749)+(1.047)+(2.021), (I-749)+(1.047)+(2.022), (I-749)+(1.047)+(2.023), (I-749)+(1.047)+(2.024), (I-749)+(1.047)+(2.025), (I-749)+(1.047)+(2.026), (I-749)+(1.047)+(2.027), (I-749)+(1.047)+(2.028), (I-749)+(1.047)+(2.029), (I-749)+(1.047)+(2.030), (I-749)+(1.047)+(2.031), (I-749)+(1.047)+(2.032), (I-749)+(1.047)+(2.033), (I-749)+(1.047)+(2.034), (I-749)+(1.047)+(2.035), (I-749)+(1.047)+(2.036), (I-749)+(1.047)+(2.037), (I-749)+(1.047)+(2.038), (I-749)+(1.047)+(2.039), (I-749)+(1.047)+(2.040), (I-749)+(1.047)+(2.041), (I-749)+(1.047)+(2.042), (I-749)+(1.047)+(2.043), (I-749)+(1.047)+(2.044), (I-749)+(1.047)+(2.045), (I-749)+(1.047)+(2.046), (I-749)+(1.047)+(2.047), (I-749)+(1.047)+(2.048), (I-749)+(1.047)+(2.049), (I-749)+(1.047)+(2.050), (I-749)+(1.047)+(2.051), (I-749)+(1.047)+(2.052), (I-749)+(1.047)+(2.053), (I-749)+(1.047)+(2.054), (I-749)+(1.047)+(2.055), (I-749)+(1.047)+(2.056), (I-749)+(1.047)+(2.057), (I-749)+(1.047)+(2.058), (I-749)+(1.047)+(2.059), (I-749)+(1.047)+(3.001), (I-749)+(1.047)+(3.002), (I-749)+(1.047)+(3.003), (I-749)+(1.047)+(3.004), (I-749)+(1.047)+(3.005), (I-749)+(1.047)+(3.006), (I-749)+(1.047)+(3.007), (I-749)+(1.047)+(3.008), (I-749)+(1.047)+(3.009), (I-749)+(1.047)+(3.010), (I-749)+(1.047)+(3.011), (I-749)+(1.047)+(3.012), (I-749)+(1.047)+(3.013), (I-749)+(1.047)+(3.014), (I-749)+(1.047)+(3.015), (I-749)+(1.047)+(3.016), (I-749)+(1.047)+(3.017), (I-749)+(1.047)+(3.018), (I-749)+(1.047)+(3.019), (I-749)+(1.047)+(3.020), (I-749)+(1.047)+(3.021), (I-749)+(1.047)+(3.022), (I-749)+(1.047)+(3.023), (I-749)+(1.047)+(3.024), (I-749)+(1.047)+(3.025), (I-749)+(1.047)+(3.026), (I-749)+(1.047)+(3.027), (I-749)+(1.047)+(3.028), (I-749)+(1.047)+(3.029), (I-749)+(1.047)+(3.030), (I-749)+(1.047)+(3.031), (I-749)+(1.047)+(5.001), (I-749)+(1.047)+(5.002), (I-749)+(1.047)+(5.003), (I-749)+(1.047)+(5.004), (I-749)+(1.047)+(5.005), (I-749)+(1.047)+(5.006), (I-749)+(1.047)+(5.007), (I-749)+(1.047)+(5.008), (I-749)+(1.047)+(5.009), (I-749)+(1.047)+(5.010), (I-749)+(1.047)+(5.011), (I-749)+(1.047)+(5.012), (I-749)+(1.047)+(5.013), (I-749)+(1.047)+(5.014), (I-749)+(1.047)+(5.015), (I-749)+(1.047)+(5.016), (I-749)+(1.047)+(5.017), (I-749)+(1.047)+(5.018), (I-749)+(1.047)+(5.019), (I-749)+(1.047)+(5.020), (I-749)+(1.047)+(5.021), (I-749)+(1.047)+(5.022), (I-749)+(1.047)+(5.023), (I-749)+(1.047)+(6.001), (I-749)+(1.047)+(6.002), (I-749)+(1.047)+(6.003), (I-749)+(1.047)+(6.004), (I-749)+(1.047)+(7.001), (I-749)+(1.047)+(7.002), (I-749)+(1.047)+(7.003), (I-749)+(1.047)+(7.004), (I-749)+(1.047)+(7.005), (I-749)+(1.047)+(7.006), (I-749)+(1.047)+(9.001), (I-749)+(1.047)+(9.002), (I-749)+(1.047)+(9.003), (I-749)+(1.047)+(9.004), (I-749)+(1.047)+(9.005), (I-749)+(1.047)+(9.006), (I-749)+(1.047)+(9.007), (I-749)+(1.047)+(9.008), (I-749)+(1.047)+(9.009), (I-749)+(1.047)+(14.001), (I-749)+(1.047)+(14.002), (I-749)+(1.047)+(15.008), (I-749)+(1.047)+(15.011), (I-749)+(1.047)+(15.012), (I-749)+(1.047)+(15.016), (I-749)+(1.047)+(15.025), (I-749)+(1.047)+(15.027), (I-749)+(1.047)+(15.047), (I-749)+(1.047)+(15.063), (I-749)+(1.047)+(15.064), (I-749)+(1.047)+(16.001), (I-749)+(1.047)+(16.002), (I-749)+(1.047)+(16.003), (I-749)+(1.047)+(16.004), (I-749)+(1.047)+(16.005), (I-749)+(1.047)+(16.006), (I-749)+(1.047)+(16.007), (I-749)+(1.047)+(16.008), (I-749)+(1.047)+(17.001), (I-749)+(1.047)+(17.002), (I-749)+(1.047)+(17.003), (I-749)+(1.047)+(17.004), (I-749)+(1.047)+(17.005), (I-749)+(1.047)+(17.006), (I-749)+(1.047)+(17.007), (I-749)+(1.047)+(17.008), (I-749)+(1.047)+(17.009), (I-749)+(1.047)+(17.010), (I-749)+(1.047)+(17.011), (I-749)+(1.047)+(17.012), (I-749)+(1.047)+(18.001),

(I-749)+(1.048)+(1.049), (I-749)+(1.048)+(1.050), (I-749)+(1.048)+(1.051), (I-749)+(1.048)+(1.052), (I-749)+(1.048)+(1.053), (I-749)+(1.048)+(1.054), (I-749)+(1.048)+(1.055), (I-749)+(1.048)+(1.056), (I-749)+(1.048)+(1.057), (I-749)+(1.048)+(1.058), (I-749)+(1.048)+(1.059), (I-749)+(1.048)+(1.060), (I-749)+(1.048)+(1.061), (I-749)+(1.048)+(1.062), (I-749)+(1.048)+(1.063), (I-749)+(1.048)+(1.064), (I-749)+(1.048)+(1.065), (I-749)+(1.048)+(1.066), (I-749)+(1.048)+(1.067), (I-749)+(1.048)+(1.068), (I-749)+(1.048)+(1.069), (I-749)+(1.048)+(1.070), (I-749)+(1.048)+(1.071), (I-749)+(1.048)+(1.072), (I-749)+(1.048)+(1.073), (I-749)+(1.048)+(1.074), (I-749)+(1.048)+(1.075), (I-749)+(1.048)+(1.076), (I-749)+(1.048)+(1.077), (I-749)+(1.048)+(1.078), (I-749)+(1.048)+(1.079), (I-749)+(1.048)+(1.080), (I-749)+(1.048)+(1.081), (I-749)+(1.048)+(1.082), (I-749)+(1.048)+(1.083), (I-749)+(1.048)+(1.084), (I-749)+(1.048)+(1.085), (I-749)+(1.048)+(1.086), (I-749)+(1.048)+(1.087), (I-749)+(1.048)+(1.088), (I-749)+(1.048)+(1.089), (I-749)+(1.048)+(1.090), (I-749)+(1.048)+(1.091), (I-749)+(1.048)+(1.092), (I-749)+(1.048)+(2.001), (I-749)+(1.048)+(2.002), (I-749)+(1.048)+(2.003), (I-749)+(1.048)+(2.004), (I-749)+(1.048)+(2.005), (I-749)+(1.048)+(2.006), (I-749)+(1.048)+(2.007), (I-749)+(1.048)+(2.008), (I-749)+(1.048)+(2.009), (I-749)+(1.048)+(2.010), (I-749)+(1.048)+(2.011), (I-749)+(1.048)+(2.012), (I-749)+(1.048)+(2.013), (I-749)+(1.048)+(2.014), (I-749)+(1.048)+(2.015), (I-749)+(1.048)+(2.016), (I-749)+(1.048)+(2.017), (I-749)+(1.048)+(2.018), (I-749)+(1.048)+(2.019), (I-749)+(1.048)+(2.020), (I-749)+(1.048)+(2.021), (I-749)+(1.048)+(2.022), (I-749)+(1.048)+(2.023), (I-749)+(1.048)+(2.024), (I-749)+(1.048)+(2.025), (I-749)+(1.048)+(2.026), (I-749)+(1.048)+(2.027), (I-749)+(1.048)+(2.028), (I-749)+(1.048)+(2.029), (I-749)+(1.048)+(2.030), (I-749)+(1.048)+(2.031), (I-749)+(1.048)+(2.032), (I-749)+(1.048)+(2.033), (I-749)+(1.048)+(2.034), (I-749)+(1.048)+(2.035), (I-749)+(1.048)+(2.036), (I-749)+(1.048)+(2.037), (I-749)+(1.048)+(2.038), (I-749)+(1.048)+(2.039), (I-749)+(1.048)+(2.040), (I-749)+(1.048)+(2.041), (I-749)+(1.048)+(2.042), (I-749)+(1.048)+(2.043), (I-749)+(1.048)+(2.044), (I-749)+(1.048)+(2.045), (I-749)+(1.048)+(2.046), (I-749)+(1.048)+(2.047), (I-749)+(1.048)+(2.048), (I-749)+(1.048)+(2.049), (I-749)+(1.048)+(2.050), (I-749)+(1.048)+(2.051), (I-749)+(1.048)+(2.052), (I-749)+(1.048)+(2.053), (I-749)+(1.048)+(2.054), (I-749)+(1.048)+(2.055), (I-749)+(1.048)+(2.056), (I-749)+(1.048)+(2.057), (I-749)+(1.048)+(2.058), (I-749)+(1.048)+(2.059), (I-749)+(1.048)+(3.001), (I-749)+(1.048)+(3.002), (I-749)+(1.048)+(3.003), (I-749)+(1.048)+(3.004), (I-749)+(1.048)+(3.005), (I-749)+(1.048)+(3.006), (I-749)+(1.048)+(3.007), (I-749)+(1.048)+(3.008), (I-749)+(1.048)+(3.009), (I-749)+(1.048)+(3.010), (I-749)+(1.048)+(3.011), (I-749)+(1.048)+(3.012), (I-749)+(1.048)+(3.013), (I-749)+(1.048)+(3.014), (I-749)+(1.048)+(3.015), (I-749)+(1.048)+(3.016), (I-749)+(1.048)+(3.017), (I-749)+(1.048)+(3.018), (I-749)+(1.048)+(3.019), (I-749)+(1.048)+(3.020), (I-749)+(1.048)+(3.021), (I-749)+(1.048)+(3.022), (I-749)+(1.048)+(3.023), (I-749)+(1.048)+(3.024), (I-749)+(1.048)+(3.025), (I-749)+(1.048)+(3.026), (I-749)+(1.048)+(3.027), (I-749)+(1.048)+(3.028), (I-749)+(1.048)+(3.029), (I-749)+(1.048)+(3.030), (I-749)+(1.048)+(3.031), (I-749)+(1.048)+(5.001), (I-749)+(1.048)+(5.002), (I-749)+(1.048)+(5.003), (I-749)+(1.048)+(5.004), (I-749)+(1.048)+(5.005), (I-749)+(1.048)+(5.006), (I-749)+(1.048)+(5.007), (I-749)+(1.048)+(5.008), (I-749)+(1.048)+(5.009), (I-749)+(1.048)+(5.010), (I-749)+(1.048)+(5.011), (I-749)+(1.048)+(5.012), (I-749)+(1.048)+(5.013), (I-749)+(1.048)+(5.014), (I-749)+(1.048)+(5.015), (I-749)+(1.048)+(5.016), (I-749)+(1.048)+(5.017), (I-749)+(1.048)+(5.018), (I-749)+(1.048)+(5.019), (I-749)+(1.048)+(5.020), (I-749)+(1.048)+(5.021), (I-749)+(1.048)+(5.022), (I-749)+(1.048)+(5.023), (I-749)+(1.048)+(6.001), (I-749)+(1.048)+(6.002), (I-749)+(1.048)+(6.003), (I-749)+(1.048)+(6.004), (I-749)+(1.048)+(7.001), (I-749)+(1.048)+(7.002), (I-749)+(1.048)+(7.003), (I-749)+(1.048)+(7.004), (I-749)+(1.048)+(7.005), (I-749)+(1.048)+(7.006), (I-749)+(1.048)+(9.001), (I-749)+(1.048)+(9.002), (I-749)+(1.048)+(9.003), (I-749)+(1.048)+(9.004), (I-749)+(1.048)+(9.005), (I-749)+(1.048)+(9.006), (I-749)+(1.048)+(9.007), (I-749)+(1.048)+(9.008), (I-749)+(1.048)+(9.009), (I-749)+(1.048)+(14.001), (I-749)+(1.048)+(14.002), (I-749)+(1.048)+(15.008), (I-749)+(1.048)+(15.011), (I-749)+(1.048)+(15.012), (I-749)+(1.048)+(15.016), (I-749)+(1.048)+(15.025), (I-749)+(1.048)+(15.027), (I-749)+(1.048)+(15.047), (I-749)+(1.048)+(15.063), (I-749)+(1.048)+(15.064), (I-749)+(1.048)+(16.001), (I-749)+(1.048)+(16.002), (I-749)+(1.048)+(16.003), (I-749)+(1.048)+(16.004), (I-749)+(1.048)+(16.005), (I-749)+(1.048)+(16.006), (I-749)+(1.048)+(16.007), (I-749)+(1.048)+(16.008), (I-749)+(1.048)+(17.001), (I-749)+(1.048)+(17.002), (I-749)+(1.048)+(17.003), (I-749)+(1.048)+(17.004), (I-749)+(1.048)+(17.005), (I-749)+(1.048)+(17.006), (I-749)+(1.048)+(17.007), (I-749)+(1.048)+(17.008), (I-749)+(1.048)+(17.009), (I-749)+(1.048)+(17.010), (I-749)+(1.048)+(17.011), (I-749)+(1.048)+(17.012), (I-749)+(1.048)+(18.001),

(I-749)+(1.049)+(1.050), (I-749)+(1.049)+(1.051), (I-749)+(1.049)+(1.052), (I-749)+(1.049)+(1.053), (I-749)+(1.049)+(1.054), (I-749)+(1.049)+(1.055), (I-749)+(1.049)+(1.056), (I-749)+(1.049)+(1.057), (I-749)+(1.049)+(1.058), (I-749)+(1.049)+(1.059), (I-749)+(1.049)+(1.060), (I-749)+(1.049)+(1.061), (I-749)+(1.049)+(1.062), (I-749)+(1.049)+(1.063), (I-749)+(1.049)+(1.064), (I-749)+(1.049)+(1.065), (I-749)+(1.049)+(1.066), (I-749)+(1.049)+(1.067), (I-749)+(1.049)+(1.068), (I-749)+(1.049)+(1.069), (I-749)+(1.049)+(1.070), (I-749)+(1.049)+(1.071), (I-749)+(1.049)+(1.072), (I-749)+(1.049)+(1.073), (I-749)+(1.049)+(1.074), (I-749)+(1.049)+(1.075), (I-749)+(1.049)+(1.076), (I-749)+(1.049)+(1.077), (I-749)+(1.049)+(1.078), (I-749)+(1.049)+(1.079), (I-749)+(1.049)+(1.080), (I-749)+(1.049)+(1.081), (I-749)+(1.049)+(1.082), (I-749)+(1.049)+(1.083), (I-749)+(1.049)+(1.084), (I-749)+(1.049)+(1.085), (I-749)+(1.049)+(1.086), (I-749)+(1.049)+(1.087), (I-749)+(1.049)+(1.088), (I-749)+(1.049)+(1.089), (I-749)+(1.049)+(1.090), (I-749)+(1.049)+(1.091), (I-749)+(1.049)+(1.092), (I-749)+(1.049)+(2.001), (I-749)+(1.049)+(2.002), (I-749)+(1.049)+(2.003), (I-749)+(1.049)+(2.004), (I-749)+(1.049)+(2.005), (I-749)+(1.049)+(2.006), (I-749)+(1.049)+(2.007), (I-749)+(1.049)+(2.008), (I-749)+(1.049)+(2.009), (I-749)+(1.049)+(2.010), (I-749)+(1.049)+(2.011), (I-749)+(1.049)+(2.012), (I-749)+(1.049)+(2.013), (I-749)+(1.049)+(2.014), (I-749)+(1.049)+(2.015), (I-749)+(1.049)+(2.016), (I-749)+(1.049)+(2.017), (I-749)+(1.049)+(2.018), (I-749)+(1.049)+(2.019), (I-749)+(1.049)+(2.020), (I-749)+(1.049)+(2.021), (I-749)+(1.049)+(2.022), (I-749)+(1.049)+(2.023), (I-749)+(1.049)+(2.024), (I-749)+(1.049)+(2.025), (I-749)+(1.049)+(2.026), (I-749)+(1.049)+(2.027), (I-749)+(1.049)+(2.028), (I-749)+(1.049)+(2.029), (I-749)+(1.049)+(2.030), (I-749)+(1.049)+(2.031), (I-749)+(1.049)+(2.032), (I-749)+(1.049)+(2.033), (I-749)+(1.049)+(2.034), (I-749)+(1.049)+(2.035), (I-749)+(1.049)+(2.036), (I-749)+(1.049)+(2.037), (I-749)+(1.049)+(2.038), (I-749)+(1.049)+(2.039), (I-749)+(1.049)+(2.040), (I-749)+(1.049)+(2.041), (I-749)+(1.049)+(2.042), (I-749)+(1.049)+(2.043), (I-749)+(1.049)+(2.044), (I-749)+(1.049)+(2.045), (I-749)+(1.049)+(2.046), (I-749)+(1.049)+(2.047), (I-749)+(1.049)+(2.048), (I-749)+(1.049)+(2.049), (I-749)+(1.049)+(2.050), (I-749)+(1.049)+(2.051), (I-749)+(1.049)+(2.052), (I-749)+(1.049)+(2.053), (I-749)+(1.049)+(2.054), (I-749)+(1.049)+(2.055), (I-749)+(1.049)+(2.056), (I-749)+(1.049)+(2.057), (I-749)+(1.049)+(2.058), (I-749)+(1.049)+(2.059), (I-749)+(1.049)+(3.001), (I-749)+(1.049)+(3.002), (I-749)+(1.049)+(3.003), (I-749)+(1.049)+(3.004), (I-749)+(1.049)+(3.005), (I-749)+(1.049)+(3.006), (I-749)+(1.049)+(3.007), (I-749)+(1.049)+(3.008), (I-749)+(1.049)+(3.009), (I-749)+(1.049)+(3.010), (I-749)+(1.049)+(3.011), (I-749)+(1.049)+(3.012), (I-749)+(1.049)+(3.013), (I-749)+(1.049)+(3.014), (I-749)+(1.049)+(3.015), (I-749)+(1.049)+(3.016), (I-749)+(1.049)+(3.017), (I-749)+(1.049)+(3.018), (I-749)+(1.049)+(3.019), (I-749)+(1.049)+(3.020), (I-749)+(1.049)+(3.021), (I-749)+(1.049)+(3.022), (I-749)+(1.049)+(3.023), (I-749)+(1.049)+(3.024), (I-749)+(1.049)+(3.025), (I-749)+(1.049)+(3.026), (I-749)+(1.049)+(3.027), (I-749)+(1.049)+(3.028), (I-749)+(1.049)+(3.029), (I-749)+(1.049)+(3.030), (I-749)+(1.049)+(3.031), (I-749)+(1.049)+(5.001), (I-749)+(1.049)+(5.002), (I-749)+(1.049)+(5.003), (I-749)+(1.049)+(5.004), (I-749)+(1.049)+(5.005), (I-749)+(1.049)+(5.006), (I-749)+(1.049)+(5.007), (I-749)+(1.049)+(5.008), (I-749)+(1.049)+(5.009), (I-749)+(1.049)+(5.010), (I-749)+(1.049)+(5.011), (I-749)+(1.049)+(5.012), (I-749)+(1.049)+(5.013), (I-749)+(1.049)+(5.014), (I-749)+(1.049)+(5.015), (I-749)+(1.049)+(5.016), (I-749)+(1.049)+(5.017), (I-749)+(1.049)+(5.018), (I-749)+(1.049)+(5.019), (I-749)+(1.049)+(5.020), (I-749)+(1.049)+(5.021), (I-749)+(1.049)+(5.022), (I-749)+(1.049)+(5.023), (I-749)+(1.049)+(6.001), (I-749)+(1.049)+(6.002), (I-749)+(1.049)+(6.003), (I-749)+(1.049)+(6.004), (I-749)+(1.049)+(7.001), (I-749)+(1.049)+(7.002), (I-749)+(1.049)+(7.003), (I-749)+(1.049)+(7.004), (I-749)+(1.049)+(7.005), (I-749)+(1.049)+(7.006), (I-749)+(1.049)+(9.001), (I-749)+(1.049)+(9.002), (I-749)+(1.049)+(9.003), (I-749)+(1.049)+(9.004), (I-749)+(1.049)+(9.005), (I-749)+(1.049)+(9.006), (I-749)+(1.049)+(9.007), (I-749)+(1.049)+(9.008), (I-749)+(1.049)+(9.009), (I-749)+(1.049)+(14.001), (I-749)+(1.049)+(14.002), (I-749)+(1.049)+(15.008), (I-749)+(1.049)+(15.011), (I-749)+(1.049)+(15.012), (I-749)+(1.049)+(15.016), (I-749)+(1.049)+(15.025), (I-749)+(1.049)+(15.027), (I-749)+(1.049)+(15.047), (I-749)+(1.049)+(15.063), (I-749)+(1.049)+(15.064), (I-749)+(1.049)+(16.001), (I-749)+(1.049)+(16.002), (I-749)+(1.049)+(16.003), (I-749)+(1.049)+(16.004), (I-749)+(1.049)+(16.005), (I-749)+(1.049)+(16.006), (I-749)+(1.049)+(16.007), (I-749)+(1.049)+(16.008), (I-749)+(1.049)+(17.001), (I-749)+(1.049)+(17.002), (I-749)+(1.049)+(17.003), (I-749)+(1.049)+(17.004), (I-749)+(1.049)+(17.005), (I-749)+(1.049)+(17.006), (I-749)+(1.049)+(17.007), (I-749)+(1.049)+(17.008), (I-749)+(1.049)+(17.009), (I-749)+(1.049)+(17.010), (I-749)+(1.049)+(17.011), (I-749)+(1.049)+(17.012), (I-749)+(1.049)+(18.001),

(I-749)+(1.050)+(1.051), (I-749)+(1.050)+(1.052), (I-749)+(1.050)+(1.053), (I-749)+(1.050)+(1.054), (I-749)+(1.050)+(1.055), (I-749)+(1.050)+(1.056), (I-749)+(1.050)+(1.057), (I-749)+(1.050)+(1.058), (I-749)+(1.050)+(1.059), (I-749)+(1.050)+(1.060), (I-749)+(1.050)+(1.061), (I-749)+(1.050)+(1.062), (I-749)+(1.050)+(1.063), (I-749)+(1.050)+(1.064), (I-749)+(1.050)+(1.065), (I-749)+(1.050)+(1.066), (I-749)+(1.050)+(1.067), (I-749)+(1.050)+(1.068), (I-749)+(1.050)+(1.069), (I-749)+(1.050)+(1.070), (I-749)+(1.050)+(1.071), (I-749)+(1.050)+(1.072), (I-749)+(1.050)+(1.073), (I-749)+(1.050)+(1.074), (I-749)+(1.050)+(1.075), (I-749)+(1.050)+(1.076), (I-749)+(1.050)+(1.077), (I-749)+(1.050)+(1.078), (I-749)+(1.050)+(1.079), (I-749)+(1.050)+(1.080), (I-749)+(1.050)+(1.081), (I-749)+(1.050)+(1.082), (I-749)+(1.050)+(1.083), (I-749)+(1.050)+(1.084), (I-749)+(1.050)+(1.085), (I-749)+(1.050)+(1.086), (I-749)+(1.050)+(1.087), (I-749)+(1.050)+(1.088), (I-749)+(1.050)+(1.089), (I-749)+(1.050)+(1.090), (I-749)+(1.050)+(1.091), (I-749)+(1.050)+(1.092), (I-749)+(1.050)+(2.001), (I-749)+(1.050)+(2.002), (I-749)+(1.050)+(2.003), (I-749)+(1.050)+(2.004), (I-749)+(1.050)+(2.005), (I-749)+(1.050)+(2.006), (I-749)+(1.050)+(2.007), (I-749)+(1.050)+(2.008), (I-749)+(1.050)+(2.009), (I-749)+(1.050)+(2.010), (I-749)+(1.050)+(2.011), (I-749)+(1.050)+(2.012), (I-749)+(1.050)+(2.013), (I-749)+(1.050)+(2.014), (I-749)+(1.050)+(2.015), (I-749)+(1.050)+(2.016), (I-749)+(1.050)+(2.017), (I-749)+(1.050)+(2.018), (I-749)+(1.050)+(2.019), (I-749)+(1.050)+(2.020), (I-749)+(1.050)+(2.021), (I-749)+(1.050)+(2.022), (I-749)+(1.050)+(2.023), (I-749)+(1.050)+(2.024), (I-749)+(1.050)+(2.025), (I-749)+(1.050)+(2.026), (I-749)+(1.050)+(2.027), (I-749)+(1.050)+(2.028), (I-749)+(1.050)+(2.029), (I-749)+(1.050)+(2.030), (I-749)+(1.050)+(2.031), (I-749)+(1.050)+(2.032), (I-749)+(1.050)+(2.033), (I-749)+(1.050)+(2.034), (I-749)+(1.050)+(2.035), (I-749)+(1.050)+(2.036), (I-749)+(1.050)+(2.037), (I-749)+(1.050)+(2.038), (I-749)+(1.050)+(2.039), (I-749)+(1.050)+(2.040), (I-749)+(1.050)+(2.041), (I-749)+(1.050)+(2.042), (I-749)+(1.050)+(2.043), (I-749)+(1.050)+(2.044), (I-749)+(1.050)+(2.045), (I-749)+(1.050)+(2.046), (I-749)+(1.050)+(2.047), (I-749)+(1.050)+(2.048), (I-749)+(1.050)+(2.049), (I-749)+(1.050)+(2.050), (I-749)+(1.050)+(2.051), (I-749)+(1.050)+(2.052), (I-749)+(1.050)+(2.053), (I-749)+(1.050)+(2.054), (I-749)+(1.050)+(2.055), (I-749)+(1.050)+(2.056), (I-749)+(1.050)+(2.057), (I-749)+(1.050)+(2.058), (I-749)+(1.050)+(2.059), (I-749)+(1.050)+(3.001), (I-749)+(1.050)+(3.002), (I-749)+(1.050)+(3.003), (I-749)+(1.050)+(3.004), (I-749)+(1.050)+(3.005), (I-749)+(1.050)+(3.006), (I-749)+(1.050)+(3.007), (I-749)+(1.050)+(3.008), (I-749)+(1.050)+(3.009), (I-749)+(1.050)+(3.010), (I-749)+(1.050)+(3.011), (I-749)+(1.050)+(3.012), (I-749)+(1.050)+(3.013), (I-749)+(1.050)+(3.014), (I-749)+(1.050)+(3.015), (I-749)+(1.050)+(3.016), (I-749)+(1.050)+(3.017), (I-749)+(1.050)+(3.018), (I-749)+(1.050)+(3.019), (I-749)+(1.050)+(3.020), (I-749)+(1.050)+(3.021), (I-749)+(1.050)+(3.022), (I-749)+(1.050)+(3.023), (I-749)+(1.050)+(3.024), (I-749)+(1.050)+(3.025), (I-749)+(1.050)+(3.026), (I-749)+(1.050)+(3.027), (I-749)+(1.050)+(3.028), (I-749)+(1.050)+(3.029), (I-749)+(1.050)+(3.030), (I-749)+(1.050)+(3.031), (I-749)+(1.050)+(5.001), (I-749)+(1.050)+(5.002), (I-749)+(1.050)+(5.003), (I-749)+(1.050)+(5.004), (I-749)+(1.050)+(5.005), (I-749)+(1.050)+(5.006), (I-749)+(1.050)+(5.007), (I-749)+(1.050)+(5.008), (I-749)+(1.050)+(5.009), (I-749)+(1.050)+(5.010), (I-749)+(1.050)+(5.011), (I-749)+(1.050)+(5.012), (I-749)+(1.050)+(5.013), (I-749)+(1.050)+(5.014), (I-749)+(1.050)+(5.015), (I-749)+(1.050)+(5.016), (I-749)+(1.050)+(5.017), (I-749)+(1.050)+(5.018), (I-749)+(1.050)+(5.019), (I-749)+(1.050)+(5.020), (I-749)+(1.050)+(5.021), (I-749)+(1.050)+(5.022), (I-749)+(1.050)+(5.023), (I-749)+(1.050)+(6.001), (I-749)+(1.050)+(6.002), (I-749)+(1.050)+(6.003), (I-749)+(1.050)+(6.004), (I-749)+(1.050)+(7.001), (I-749)+(1.050)+(7.002), (I-749)+(1.050)+(7.003), (I-749)+(1.050)+(7.004), (I-749)+(1.050)+(7.005), (I-749)+(1.050)+(7.006), (I-749)+(1.050)+(9.001), (I-749)+(1.050)+(9.002), (I-749)+(1.050)+(9.003), (I-749)+(1.050)+(9.004), (I-749)+(1.050)+(9.005), (I-749)+(1.050)+(9.006), (I-749)+(1.050)+(9.007), (I-749)+(1.050)+(9.008), (I-749)+(1.050)+(9.009), (I-749)+(1.050)+(14.001), (I-749)+(1.050)+(14.002), (I-749)+(1.050)+(15.008), (I-749)+(1.050)+(15.011), (I-749)+(1.050)+(15.012), (I-749)+(1.050)+(15.016), (I-749)+(1.050)+(15.025), (I-749)+(1.050)+(15.027), (I-749)+(1.050)+(15.047), (I-749)+(1.050)+(15.063), (I-749)+(1.050)+(15.064), (I-749)+(1.050)+(16.001), (I-749)+(1.050)+(16.002), (I-749)+(1.050)+(16.003), (I-749)+(1.050)+(16.004), (I-749)+(1.050)+(16.005), (I-749)+(1.050)+(16.006), (I-749)+(1.050)+(16.007), (I-749)+(1.050)+(16.008), (I-749)+(1.050)+(17.001), (I-749)+(1.050)+(17.002), (I-749)+(1.050)+(17.003), (I-749)+(1.050)+(17.004), (I-749)+(1.050)+(17.005), (I-749)+(1.050)+(17.006), (I-749)+(1.050)+(17.007), (I-749)+(1.050)+(17.008), (I-749)+(1.050)+(17.009), (I-749)+(1.050)+(17.010), (I-749)+(1.050)+(17.011), (I-749)+(1.050)+(17.012), (I-749)+(1.050)+(18.001),

(I-749)+(1.051)+(1.052), (I-749)+(1.051)+(1.053), (I-749)+(1.051)+(1.054), (I-749)+(1.051)+(1.055), (I-749)+(1.051)+(1.056), (I-749)+(1.051)+(1.057), (I-749)+(1.051)+(1.058), (I-749)+(1.051)+(1.059), (I-749)+(1.051)+(1.060), (I-749)+(1.051)+(1.061), (I-749)+(1.051)+(1.062), (I-749)+(1.051)+(1.063), (I-749)+(1.051)+(1.064), (I-749)+(1.051)+(1.065), (I-749)+(1.051)+(1.066), (I-749)+(1.051)+(1.067), (I-749)+(1.051)+(1.068), (I-749)+(1.051)+(1.069), (I-749)+(1.051)+(1.070), (I-749)+(1.051)+(1.071), (I-749)+(1.051)+(1.072), (I-749)+(1.051)+(1.073), (I-749)+(1.051)+(1.074), (I-749)+(1.051)+(1.075), (I-749)+(1.051)+(1.076), (I-749)+(1.051)+(1.077), (I-749)+(1.051)+(1.078), (I-749)+(1.051)+(1.079), (I-749)+(1.051)+(1.080), (I-749)+(1.051)+(1.081), (I-749)+(1.051)+(1.082), (I-749)+(1.051)+(1.083), (I-749)+(1.051)+(1.084), (I-749)+(1.051)+(1.085), (I-749)+(1.051)+(1.086), (I-749)+(1.051)+(1.087), (I-749)+(1.051)+(1.088), (I-749)+(1.051)+(1.089), (I-749)+(1.051)+(1.090), (I-749)+(1.051)+(1.091), (I-749)+(1.051)+(1.092), (I-749)+(1.051)+(2.001), (I-749)+(1.051)+(2.002), (I-749)+(1.051)+(2.003), (I-749)+(1.051)+(2.004), (I-749)+(1.051)+(2.005), (I-749)+(1.051)+(2.006), (I-749)+(1.051)+(2.007), (I-749)+(1.051)+(2.008), (I-749)+(1.051)+(2.009), (I-749)+(1.051)+(2.010), (I-749)+(1.051)+(2.011), (I-749)+(1.051)+(2.012), (I-749)+(1.051)+(2.013), (I-749)+(1.051)+(2.014), (I-749)+(1.051)+(2.015), (I-749)+(1.051)+(2.016), (I-749)+(1.051)+(2.017), (I-749)+(1.051)+(2.018), (I-749)+(1.051)+(2.019), (I-749)+(1.051)+(2.020), (I-749)+(1.051)+(2.021), (I-749)+(1.051)+(2.022), (I-749)+(1.051)+(2.023), (I-749)+(1.051)+(2.024), (I-749)+(1.051)+(2.025), (I-749)+(1.051)+(2.026), (I-749)+(1.051)+(2.027), (I-749)+(1.051)+(2.028), (I-749)+(1.051)+(2.029), (I-749)+(1.051)+(2.030), (I-749)+(1.051)+(2.031), (I-749)+(1.051)+(2.032), (I-749)+(1.051)+(2.033), (I-749)+(1.051)+(2.034), (I-749)+(1.051)+(2.035), (I-749)+(1.051)+(2.036), (I-749)+(1.051)+(2.037), (I-749)+(1.051)+(2.038), (I-749)+(1.051)+(2.039), (I-749)+(1.051)+(2.040), (I-749)+(1.051)+(2.041), (I-749)+(1.051)+(2.042), (I-749)+(1.051)+(2.043), (I-749)+(1.051)+(2.044), (I-749)+(1.051)+(2.045), (I-749)+(1.051)+(2.046), (I-749)+(1.051)+(2.047), (I-749)+(1.051)+(2.048), (I-749)+(1.051)+(2.049), (I-749)+(1.051)+(2.050), (I-749)+(1.051)+(2.051), (I-749)+(1.051)+(2.052), (I-749)+(1.051)+(2.053), (I-749)+(1.051)+(2.054), (I-749)+(1.051)+(2.055), (I-749)+(1.051)+(2.056), (I-749)+(1.051)+(2.057), (I-749)+(1.051)+(2.058), (I-749)+(1.051)+(2.059), (I-749)+(1.051)+(3.001), (I-749)+(1.051)+(3.002), (I-749)+(1.051)+(3.003), (I-749)+(1.051)+(3.004), (I-749)+(1.051)+(3.005), (I-749)+(1.051)+(3.006), (I-749)+(1.051)+(3.007), (I-749)+(1.051)+(3.008), (I-749)+(1.051)+(3.009), (I-749)+(1.051)+(3.010), (I-749)+(1.051)+(3.011), (I-749)+(1.051)+(3.012), (I-749)+(1.051)+(3.013), (I-749)+(1.051)+(3.014), (I-749)+(1.051)+(3.015), (I-749)+(1.051)+(3.016), (I-749)+(1.051)+(3.017), (I-749)+(1.051)+(3.018), (I-749)+(1.051)+(3.019), (I-749)+(1.051)+(3.020), (I-749)+(1.051)+(3.021), (I-749)+(1.051)+(3.022), (I-749)+(1.051)+(3.023), (I-749)+(1.051)+(3.024), (I-749)+(1.051)+(3.025), (I-749)+(1.051)+(3.026), (I-749)+(1.051)+(3.027), (I-749)+(1.051)+(3.028), (I-749)+(1.051)+(3.029), (I-749)+(1.051)+(3.030), (I-749)+(1.051)+(3.031), (I-749)+(1.051)+(5.001), (I-749)+(1.051)+(5.002), (I-749)+(1.051)+(5.003), (I-749)+(1.051)+(5.004), (I-749)+(1.051)+(5.005), (I-749)+(1.051)+(5.006), (I-749)+(1.051)+(5.007), (I-749)+(1.051)+(5.008), (I-749)+(1.051)+(5.009), (I-749)+(1.051)+(5.010), (I-749)+(1.051)+(5.011), (I-749)+(1.051)+(5.012), (I-749)+(1.051)+(5.013), (I-749)+(1.051)+(5.014), (I-749)+(1.051)+(5.015), (I-749)+(1.051)+(5.016), (I-749)+(1.051)+(5.017), (I-749)+(1.051)+(5.018), (I-749)+(1.051)+(5.019), (I-749)+(1.051)+(5.020), (I-749)+(1.051)+(5.021), (I-749)+(1.051)+(5.022), (I-749)+(1.051)+(5.023), (I-749)+(1.051)+(6.001), (I-749)+(1.051)+(6.002), (I-749)+(1.051)+(6.003), (I-749)+(1.051)+(6.004), (I-749)+(1.051)+(7.001), (I-749)+(1.051)+(7.002), (I-749)+(1.051)+(7.003), (I-749)+(1.051)+(7.004), (I-749)+(1.051)+(7.005), (I-749)+(1.051)+(7.006), (I-749)+(1.051)+(9.001), (I-749)+(1.051)+(9.002), (I-749)+(1.051)+(9.003), (I-749)+(1.051)+(9.004), (I-749)+(1.051)+(9.005), (I-749)+(1.051)+(9.006), (I-749)+(1.051)+(9.007), (I-749)+(1.051)+(9.008), (I-749)+(1.051)+(9.009), (I-749)+(1.051)+(14.001), (I-749)+(1.051)+(14.002), (I-749)+(1.051)+(15.008), (I-749)+(1.051)+(15.011), (I-749)+(1.051)+(15.012), (I-749)+(1.051)+(15.016), (I-749)+(1.051)+(15.025), (I-749)+(1.051)+(15.027), (I-749)+(1.051)+(15.047), (I-749)+(1.051)+(15.063), (I-749)+(1.051)+(15.064), (I-749)+(1.051)+(16.001), (I-749)+(1.051)+(16.002), (I-749)+(1.051)+(16.003), (I-749)+(1.051)+(16.004), (I-749)+(1.051)+(16.005), (I-749)+(1.051)+(16.006), (I-749)+(1.051)+(16.007), (I-749)+(1.051)+(16.008), (I-749)+(1.051)+(17.001), (I-749)+(1.051)+(17.002), (I-749)+(1.051)+(17.003), (I-749)+(1.051)+(17.004), (I-749)+(1.051)+(17.005), (I-749)+(1.051)+(17.006), (I-749)+(1.051)+(17.007), (I-749)+(1.051)+(17.008), (I-749)+(1.051)+(17.009), (I-749)+(1.051)+(17.010), (I-749)+(1.051)+(17.011), (I-749)+(1.051)+(17.012), (I-749)+(1.051)+(18.001),

(I-749)+(1.052)+(1.053), (I-749)+(1.052)+(1.054), (I-749)+(1.052)+(1.055), (I-749)+(1.052)+(1.056), (I-749)+(1.052)+(1.057), (I-749)+(1.052)+(1.058), (I-749)+(1.052)+(1.059), (I-749)+(1.052)+(1.060), (I-749)+(1.052)+(1.061), (I-749)+(1.052)+(1.062), (I-749)+(1.052)+(1.063), (I-749)+(1.052)+(1.064), (I-749)+(1.052)+(1.065), (I-749)+(1.052)+(1.066), (I-749)+(1.052)+(1.067), (I-749)+(1.052)+(1.068), (I-749)+(1.052)+(1.069), (I-749)+(1.052)+(1.070), (I-749)+(1.052)+(1.071), (I-749)+(1.052)+(1.072), (I-749)+(1.052)+(1.073), (I-749)+(1.052)+(1.074), (I-749)+(1.052)+(1.075), (I-749)+(1.052)+(1.076), (I-749)+(1.052)+(1.077), (I-749)+(1.052)+(1.078), (I-749)+(1.052)+(1.079), (I-749)+(1.052)+(1.080), (I-749)+(1.052)+(1.081), (I-749)+(1.052)+(1.082), (I-749)+(1.052)+(1.083), (I-749)+(1.052)+(1.084), (I-749)+(1.052)+(1.085), (I-749)+(1.052)+(1.086), (I-749)+(1.052)+(1.087), (I-749)+(1.052)+(1.088), (I-749)+(1.052)+(1.089), (I-749)+(1.052)+(1.090), (I-749)+(1.052)+(1.091), (I-749)+(1.052)+(1.092), (I-749)+(1.052)+(2.001), (I-749)+(1.052)+(2.002), (I-749)+(1.052)+(2.003), (I-749)+(1.052)+(2.004), (I-749)+(1.052)+(2.005), (I-749)+(1.052)+(2.006), (I-749)+(1.052)+(2.007), (I-749)+(1.052)+(2.008), (I-749)+(1.052)+(2.009), (I-749)+(1.052)+(2.010), (I-749)+(1.052)+(2.011), (I-749)+(1.052)+(2.012), (I-749)+(1.052)+(2.013), (I-749)+(1.052)+(2.014), (I-749)+(1.052)+(2.015), (I-749)+(1.052)+(2.016), (I-749)+(1.052)+(2.017), (I-749)+(1.052)+(2.018), (I-749)+(1.052)+(2.019), (I-749)+(1.052)+(2.020), (I-749)+(1.052)+(2.021), (I-749)+(1.052)+(2.022), (I-749)+(1.052)+(2.023), (I-749)+(1.052)+(2.024), (I-749)+(1.052)+(2.025), (I-749)+(1.052)+(2.026), (I-749)+(1.052)+(2.027), (I-749)+(1.052)+(2.028), (I-749)+(1.052)+(2.029), (I-749)+(1.052)+(2.030), (I-749)+(1.052)+(2.031), (I-749)+(1.052)+(2.032), (I-749)+(1.052)+(2.033), (I-749)+(1.052)+(2.034), (I-749)+(1.052)+(2.035), (I-749)+(1.052)+(2.036), (I-749)+(1.052)+(2.037), (I-749)+(1.052)+(2.038), (I-749)+(1.052)+(2.039), (I-749)+(1.052)+(2.040), (I-749)+(1.052)+(2.041), (I-749)+(1.052)+(2.042), (I-749)+(1.052)+(2.043), (I-749)+(1.052)+(2.044), (I-749)+(1.052)+(2.045), (I-749)+(1.052)+(2.046), (I-749)+(1.052)+(2.047), (I-749)+(1.052)+(2.048), (I-749)+(1.052)+(2.049), (I-749)+(1.052)+(2.050), (I-749)+(1.052)+(2.051), (I-749)+(1.052)+(2.052), (I-749)+(1.052)+(2.053), (I-749)+(1.052)+(2.054), (I-749)+(1.052)+(2.055), (I-749)+(1.052)+(2.056), (I-749)+(1.052)+(2.057), (I-749)+(1.052)+(2.058), (I-749)+(1.052)+(2.059), (I-749)+(1.052)+(3.001), (I-749)+(1.052)+(3.002), (I-749)+(1.052)+(3.003), (I-749)+(1.052)+(3.004), (I-749)+(1.052)+(3.005), (I-749)+(1.052)+(3.006), (I-749)+(1.052)+(3.007), (I-749)+(1.052)+(3.008), (I-749)+(1.052)+(3.009), (I-749)+(1.052)+(3.010), (I-749)+(1.052)+(3.011), (I-749)+(1.052)+(3.012), (I-749)+(1.052)+(3.013), (I-749)+(1.052)+(3.014), (I-749)+(1.052)+(3.015), (I-749)+(1.052)+(3.016), (I-749)+(1.052)+(3.017), (I-749)+(1.052)+(3.018), (I-749)+(1.052)+(3.019), (I-749)+(1.052)+(3.020), (I-749)+(1.052)+(3.021), (I-749)+(1.052)+(3.022), (I-749)+(1.052)+(3.023), (I-749)+(1.052)+(3.024), (I-749)+(1.052)+(3.025), (I-749)+(1.052)+(3.026), (I-749)+(1.052)+(3.027), (I-749)+(1.052)+(3.028), (I-749)+(1.052)+(3.029), (I-749)+(1.052)+(3.030), (I-749)+(1.052)+(3.031), (I-749)+(1.052)+(5.001), (I-749)+(1.052)+(5.002), (I-749)+(1.052)+(5.003), (I-749)+(1.052)+(5.004), (I-749)+(1.052)+(5.005), (I-749)+(1.052)+(5.006), (I-749)+(1.052)+(5.007), (I-749)+(1.052)+(5.008), (I-749)+(1.052)+(5.009), (I-749)+(1.052)+(5.010), (I-749)+(1.052)+(5.011), (I-749)+(1.052)+(5.012), (I-749)+(1.052)+(5.013), (I-749)+(1.052)+(5.014), (I-749)+(1.052)+(5.015), (I-749)+(1.052)+(5.016), (I-749)+(1.052)+(5.017), (I-749)+(1.052)+(5.018), (I-749)+(1.052)+(5.019), (I-749)+(1.052)+(5.020), (I-749)+(1.052)+(5.021), (I-749)+(1.052)+(5.022), (I-749)+(1.052)+(5.023), (I-749)+(1.052)+(6.001), (I-749)+(1.052)+(6.002), (I-749)+(1.052)+(6.003), (I-749)+(1.052)+(6.004), (I-749)+(1.052)+(7.001), (I-749)+(1.052)+(7.002), (I-749)+(1.052)+(7.003), (I-749)+(1.052)+(7.004), (I-749)+(1.052)+(7.005), (I-749)+(1.052)+(7.006), (I-749)+(1.052)+(9.001), (I-749)+(1.052)+(9.002), (I-749)+(1.052)+(9.003), (I-749)+(1.052)+(9.004), (I-749)+(1.052)+(9.005), (I-749)+(1.052)+(9.006), (I-749)+(1.052)+(9.007), (I-749)+(1.052)+(9.008), (I-749)+(1.052)+(9.009), (I-749)+(1.052)+(14.001), (I-749)+(1.052)+(14.002), (I-749)+(1.052)+(15.008), (I-749)+(1.052)+(15.011), (I-749)+(1.052)+(15.012), (I-749)+(1.052)+(15.016), (I-749)+(1.052)+(15.025), (I-749)+(1.052)+(15.027), (I-749)+(1.052)+(15.047), (I-749)+(1.052)+(15.063), (I-749)+(1.052)+(15.064), (I-749)+(1.052)+(16.001), (I-749)+(1.052)+(16.002), (I-749)+(1.052)+(16.003), (I-749)+(1.052)+(16.004), (I-749)+(1.052)+(16.005), (I-749)+(1.052)+(16.006), (I-749)+(1.052)+(16.007), (I-749)+(1.052)+(16.008), (I-749)+(1.052)+(17.001), (I-749)+(1.052)+(17.002), (I-749)+(1.052)+(17.003), (I-749)+(1.052)+(17.004), (I-749)+(1.052)+(17.005), (I-749)+(1.052)+(17.006), (I-749)+(1.052)+(17.007), (I-749)+(1.052)+(17.008), (I-749)+(1.052)+(17.009), (I-749)+(1.052)+(17.010), (I-749)+(1.052)+(17.011), (I-749)+(1.052)+(17.012), (I-749)+(1.052)+(18.001),

(I-749)+(1.053)+(1.054), (I-749)+(1.053)+(1.055), (I-749)+(1.053)+(1.056), (I-749)+(1.053)+(1.057), (I-749)+(1.053)+(1.058), (I-749)+(1.053)+(1.059), (I-749)+(1.053)+(1.060), (I-749)+(1.053)+(1.061), (I-749)+(1.053)+(1.062), (I-749)+(1.053)+(1.063), (I-749)+(1.053)+(1.064), (I-749)+(1.053)+(1.065), (I-749)+(1.053)+(1.066), (I-749)+(1.053)+(1.067), (I-749)+(1.053)+(1.068), (I-749)+(1.053)+(1.069), (I-749)+(1.053)+(1.070), (I-749)+(1.053)+(1.071), (I-749)+(1.053)+(1.072), (I-749)+(1.053)+(1.073), (I-749)+(1.053)+(1.074), (I-749)+(1.053)+(1.075), (I-749)+(1.053)+(1.076), (I-749)+(1.053)+(1.077), (I-749)+(1.053)+(1.078), (I-749)+(1.053)+(1.079), (I-749)+(1.053)+(1.080), (I-749)+(1.053)+(1.081), (I-749)+(1.053)+(1.082), (I-749)+(1.053)+(1.083), (I-749)+(1.053)+(1.084), (I-749)+(1.053)+(1.085), (I-749)+(1.053)+(1.086), (I-749)+(1.053)+(1.087), (I-749)+(1.053)+(1.088), (I-749)+(1.053)+(1.089), (I-749)+(1.053)+(1.090), (I-749)+(1.053)+(1.091), (I-749)+(1.053)+(1.092), (I-749)+(1.053)+(2.001), (I-749)+(1.053)+(2.002), (I-749)+(1.053)+(2.003), (I-749)+(1.053)+(2.004), (I-749)+(1.053)+(2.005), (I-749)+(1.053)+(2.006), (I-749)+(1.053)+(2.007), (I-749)+(1.053)+(2.008), (I-749)+(1.053)+(2.009), (I-749)+(1.053)+(2.010), (I-749)+(1.053)+(2.011), (I-749)+(1.053)+(2.012), (I-749)+(1.053)+(2.013), (I-749)+(1.053)+(2.014), (I-749)+(1.053)+(2.015), (I-749)+(1.053)+(2.016), (I-749)+(1.053)+(2.017), (I-749)+(1.053)+(2.018), (I-749)+(1.053)+(2.019), (I-749)+(1.053)+(2.020), (I-749)+(1.053)+(2.021), (I-749)+(1.053)+(2.022), (I-749)+(1.053)+(2.023), (I-749)+(1.053)+(2.024), (I-749)+(1.053)+(2.025), (I-749)+(1.053)+(2.026), (I-749)+(1.053)+(2.027), (I-749)+(1.053)+(2.028), (I-749)+(1.053)+(2.029), (I-749)+(1.053)+(2.030), (I-749)+(1.053)+(2.031), (I-749)+(1.053)+(2.032), (I-749)+(1.053)+(2.033), (I-749)+(1.053)+(2.034), (I-749)+(1.053)+(2.035), (I-749)+(1.053)+(2.036), (I-749)+(1.053)+(2.037), (I-749)+(1.053)+(2.038), (I-749)+(1.053)+(2.039), (I-749)+(1.053)+(2.040), (I-749)+(1.053)+(2.041), (I-749)+(1.053)+(2.042), (I-749)+(1.053)+(2.043), (I-749)+(1.053)+(2.044), (I-749)+(1.053)+(2.045), (I-749)+(1.053)+(2.046), (I-749)+(1.053)+(2.047), (I-749)+(1.053)+(2.048), (I-749)+(1.053)+(2.049), (I-749)+(1.053)+(2.050), (I-749)+(1.053)+(2.051), (I-749)+(1.053)+(2.052), (I-749)+(1.053)+(2.053), (I-749)+(1.053)+(2.054), (I-749)+(1.053)+(2.055), (I-749)+(1.053)+(2.056), (I-749)+(1.053)+(2.057), (I-749)+(1.053)+(2.058), (I-749)+(1.053)+(2.059), (I-749)+(1.053)+(3.001), (I-749)+(1.053)+(3.002), (I-749)+(1.053)+(3.003), (I-749)+(1.053)+(3.004), (I-749)+(1.053)+(3.005), (I-749)+(1.053)+(3.006), (I-749)+(1.053)+(3.007), (I-749)+(1.053)+(3.008), (I-749)+(1.053)+(3.009), (I-749)+(1.053)+(3.010), (I-749)+(1.053)+(3.011), (I-749)+(1.053)+(3.012), (I-749)+(1.053)+(3.013), (I-749)+(1.053)+(3.014), (I-749)+(1.053)+(3.015), (I-749)+(1.053)+(3.016), (I-749)+(1.053)+(3.017), (I-749)+(1.053)+(3.018), (I-749)+(1.053)+(3.019), (I-749)+(1.053)+(3.020), (I-749)+(1.053)+(3.021), (I-749)+(1.053)+(3.022), (I-749)+(1.053)+(3.023), (I-749)+(1.053)+(3.024), (I-749)+(1.053)+(3.025), (I-749)+(1.053)+(3.026), (I-749)+(1.053)+(3.027), (I-749)+(1.053)+(3.028), (I-749)+(1.053)+(3.029), (I-749)+(1.053)+(3.030), (I-749)+(1.053)+(3.031), (I-749)+(1.053)+(5.001), (I-749)+(1.053)+(5.002), (I-749)+(1.053)+(5.003), (I-749)+(1.053)+(5.004), (I-749)+(1.053)+(5.005), (I-749)+(1.053)+(5.006), (I-749)+(1.053)+(5.007), (I-749)+(1.053)+(5.008), (I-749)+(1.053)+(5.009), (I-749)+(1.053)+(5.010), (I-749)+(1.053)+(5.011), (I-749)+(1.053)+(5.012), (I-749)+(1.053)+(5.013), (I-749)+(1.053)+(5.014), (I-749)+(1.053)+(5.015), (I-749)+(1.053)+(5.016), (I-749)+(1.053)+(5.017), (I-749)+(1.053)+(5.018), (I-749)+(1.053)+(5.019), (I-749)+(1.053)+(5.020), (I-749)+(1.053)+(5.021), (I-749)+(1.053)+(5.022), (I-749)+(1.053)+(5.023), (I-749)+(1.053)+(6.001), (I-749)+(1.053)+(6.002), (I-749)+(1.053)+(6.003), (I-749)+(1.053)+(6.004), (I-749)+(1.053)+(7.001), (I-749)+(1.053)+(7.002), (I-749)+(1.053)+(7.003), (I-749)+(1.053)+(7.004), (I-749)+(1.053)+(7.005), (I-749)+(1.053)+(7.006), (I-749)+(1.053)+(9.001), (I-749)+(1.053)+(9.002), (I-749)+(1.053)+(9.003), (I-749)+(1.053)+(9.004), (I-749)+(1.053)+(9.005), (I-749)+(1.053)+(9.006), (I-749)+(1.053)+(9.007), (I-749)+(1.053)+(9.008), (I-749)+(1.053)+(9.009), (I-749)+(1.053)+(14.001), (I-749)+(1.053)+(14.002), (I-749)+(1.053)+(15.008), (I-749)+(1.053)+(15.011), (I-749)+(1.053)+(15.012), (I-749)+(1.053)+(15.016), (I-749)+(1.053)+(15.025), (I-749)+(1.053)+(15.027), (I-749)+(1.053)+(15.047), (I-749)+(1.053)+(15.063), (I-749)+(1.053)+(15.064), (I-749)+(1.053)+(16.001), (I-749)+(1.053)+(16.002), (I-749)+(1.053)+(16.003), (I-749)+(1.053)+(16.004), (I-749)+(1.053)+(16.005), (I-749)+(1.053)+(16.006), (I-749)+(1.053)+(16.007), (I-749)+(1.053)+(16.008), (I-749)+(1.053)+(17.001), (I-749)+(1.053)+(17.002), (I-749)+(1.053)+(17.003), (I-749)+(1.053)+(17.004), (I-749)+(1.053)+(17.005), (I-749)+(1.053)+(17.006), (I-749)+(1.053)+(17.007), (I-749)+(1.053)+(17.008), (I-749)+(1.053)+(17.009), (I-749)+(1.053)+(17.010), (I-749)+(1.053)+(17.011), (I-749)+(1.053)+(17.012), (I-749)+(1.053)+(18.001),

(I-749)+(1.054)+(1.055), (I-749)+(1.054)+(1.056), (I-749)+(1.054)+(1.057), (I-749)+(1.054)+(1.058), (I-749)+(1.054)+(1.059), (I-749)+(1.054)+(1.060), (I-749)+(1.054)+(1.061), (I-749)+(1.054)+(1.062), (I-749)+(1.054)+(1.063), (I-749)+(1.054)+(1.064), (I-749)+(1.054)+(1.065), (I-749)+(1.054)+(1.066), (I-749)+(1.054)+(1.067), (I-749)+(1.054)+(1.068), (I-749)+(1.054)+(1.069), (I-749)+(1.054)+(1.070), (I-749)+(1.054)+(1.071), (I-749)+(1.054)+(1.072), (I-749)+(1.054)+(1.073), (I-749)+(1.054)+(1.074), (I-749)+(1.054)+(1.075), (I-749)+(1.054)+(1.076), (I-749)+(1.054)+(1.077), (I-749)+(1.054)+(1.078), (I-749)+(1.054)+(1.079), (I-749)+(1.054)+(1.080), (I-749)+(1.054)+(1.081), (I-749)+(1.054)+(1.082), (I-749)+(1.054)+(1.083), (I-749)+(1.054)+(1.084), (I-749)+(1.054)+(1.085), (I-749)+(1.054)+(1.086), (I-749)+(1.054)+(1.087), (I-749)+(1.054)+(1.088), (I-749)+(1.054)+(1.089), (I-749)+(1.054)+(1.090), (I-749)+(1.054)+(1.091), (I-749)+(1.054)+(1.092), (I-749)+(1.054)+(2.001), (I-749)+(1.054)+(2.002), (I-749)+(1.054)+(2.003), (I-749)+(1.054)+(2.004), (I-749)+(1.054)+(2.005), (I-749)+(1.054)+(2.006), (I-749)+(1.054)+(2.007), (I-749)+(1.054)+(2.008), (I-749)+(1.054)+(2.009), (I-749)+(1.054)+(2.010), (I-749)+(1.054)+(2.011), (I-749)+(1.054)+(2.012), (I-749)+(1.054)+(2.013), (I-749)+(1.054)+(2.014), (I-749)+(1.054)+(2.015), (I-749)+(1.054)+(2.016), (I-749)+(1.054)+(2.017), (I-749)+(1.054)+(2.018), (I-749)+(1.054)+(2.019), (I-749)+(1.054)+(2.020), (I-749)+(1.054)+(2.021), (I-749)+(1.054)+(2.022), (I-749)+(1.054)+(2.023), (I-749)+(1.054)+(2.024), (I-749)+(1.054)+(2.025), (I-749)+(1.054)+(2.026), (I-749)+(1.054)+(2.027), (I-749)+(1.054)+(2.028), (I-749)+(1.054)+(2.029), (I-749)+(1.054)+(2.030), (I-749)+(1.054)+(2.031), (I-749)+(1.054)+(2.032), (I-749)+(1.054)+(2.033), (I-749)+(1.054)+(2.034), (I-749)+(1.054)+(2.035), (I-749)+(1.054)+(2.036), (I-749)+(1.054)+(2.037), (I-749)+(1.054)+(2.038), (I-749)+(1.054)+(2.039), (I-749)+(1.054)+(2.040), (I-749)+(1.054)+(2.041), (I-749)+(1.054)+(2.042), (I-749)+(1.054)+(2.043), (I-749)+(1.054)+(2.044), (I-749)+(1.054)+(2.045), (I-749)+(1.054)+(2.046), (I-749)+(1.054)+(2.047), (I-749)+(1.054)+(2.048), (I-749)+(1.054)+(2.049), (I-749)+(1.054)+(2.050), (I-749)+(1.054)+(2.051), (I-749)+(1.054)+(2.052), (I-749)+(1.054)+(2.053), (I-749)+(1.054)+(2.054), (I-749)+(1.054)+(2.055), (I-749)+(1.054)+(2.056), (I-749)+(1.054)+(2.057), (I-749)+(1.054)+(2.058), (I-749)+(1.054)+(2.059), (I-749)+(1.054)+(3.001), (I-749)+(1.054)+(3.002), (I-749)+(1.054)+(3.003), (I-749)+(1.054)+(3.004), (I-749)+(1.054)+(3.005), (I-749)+(1.054)+(3.006), (I-749)+(1.054)+(3.007), (I-749)+(1.054)+(3.008), (I-749)+(1.054)+(3.009), (I-749)+(1.054)+(3.010), (I-749)+(1.054)+(3.011), (I-749)+(1.054)+(3.012), (I-749)+(1.054)+(3.013), (I-749)+(1.054)+(3.014), (I-749)+(1.054)+(3.015), (I-749)+(1.054)+(3.016), (I-749)+(1.054)+(3.017), (I-749)+(1.054)+(3.018), (I-749)+(1.054)+(3.019), (I-749)+(1.054)+(3.020), (I-749)+(1.054)+(3.021), (I-749)+(1.054)+(3.022), (I-749)+(1.054)+(3.023), (I-749)+(1.054)+(3.024), (I-749)+(1.054)+(3.025), (I-749)+(1.054)+(3.026), (I-749)+(1.054)+(3.027), (I-749)+(1.054)+(3.028), (I-749)+(1.054)+(3.029), (I-749)+(1.054)+(3.030), (I-749)+(1.054)+(3.031), (I-749)+(1.054)+(5.001), (I-749)+(1.054)+(5.002), (I-749)+(1.054)+(5.003), (I-749)+(1.054)+(5.004), (I-749)+(1.054)+(5.005), (I-749)+(1.054)+(5.006), (I-749)+(1.054)+(5.007), (I-749)+(1.054)+(5.008), (I-749)+(1.054)+(5.009), (I-749)+(1.054)+(5.010), (I-749)+(1.054)+(5.011), (I-749)+(1.054)+(5.012), (I-749)+(1.054)+(5.013), (I-749)+(1.054)+(5.014), (I-749)+(1.054)+(5.015), (I-749)+(1.054)+(5.016), (I-749)+(1.054)+(5.017), (I-749)+(1.054)+(5.018), (I-749)+(1.054)+(5.019), (I-749)+(1.054)+(5.020), (I-749)+(1.054)+(5.021), (I-749)+(1.054)+(5.022), (I-749)+(1.054)+(5.023), (I-749)+(1.054)+(6.001), (I-749)+(1.054)+(6.002), (I-749)+(1.054)+(6.003), (I-749)+(1.054)+(6.004), (I-749)+(1.054)+(7.001), (I-749)+(1.054)+(7.002), (I-749)+(1.054)+(7.003), (I-749)+(1.054)+(7.004), (I-749)+(1.054)+(7.005), (I-749)+(1.054)+(7.006), (I-749)+(1.054)+(9.001), (I-749)+(1.054)+(9.002), (I-749)+(1.054)+(9.003), (I-749)+(1.054)+(9.004), (I-749)+(1.054)+(9.005), (I-749)+(1.054)+(9.006), (I-749)+(1.054)+(9.007), (I-749)+(1.054)+(9.008), (I-749)+(1.054)+(9.009), (I-749)+(1.054)+(14.001), (I-749)+(1.054)+(14.002), (I-749)+(1.054)+(15.008), (I-749)+(1.054)+(15.011), (I-749)+(1.054)+(15.012), (I-749)+(1.054)+(15.016), (I-749)+(1.054)+(15.025), (I-749)+(1.054)+(15.027), (I-749)+(1.054)+(15.047), (I-749)+(1.054)+(15.063), (I-749)+(1.054)+(15.064), (I-749)+(1.054)+(16.001), (I-749)+(1.054)+(16.002), (I-749)+(1.054)+(16.003), (I-749)+(1.054)+(16.004), (I-749)+(1.054)+(16.005), (I-749)+(1.054)+(16.006), (I-749)+(1.054)+(16.007), (I-749)+(1.054)+(16.008), (I-749)+(1.054)+(17.001), (I-749)+(1.054)+(17.002), (I-749)+(1.054)+(17.003), (I-749)+(1.054)+(17.004), (I-749)+(1.054)+(17.005), (I-749)+(1.054)+(17.006), (I-749)+(1.054)+(17.007), (I-749)+(1.054)+(17.008), (I-749)+(1.054)+(17.009), (I-749)+(1.054)+(17.010), (I-749)+(1.054)+(17.011), (I-749)+(1.054)+(17.012), (I-749)+(1.054)+(18.001),

(I-749)+(1.055)+(1.056), (I-749)+(1.055)+(1.057), (I-749)+(1.055)+(1.058), (I-749)+(1.055)+(1.059), (I-749)+(1.055)+(1.060), (I-749)+(1.055)+(1.061), (I-749)+(1.055)+(1.062), (I-749)+(1.055)+(1.063), (I-749)+(1.055)+(1.064), (I-749)+(1.055)+(1.065), (I-749)+(1.055)+(1.066), (I-749)+(1.055)+(1.067), (I-749)+(1.055)+(1.068), (I-749)+(1.055)+(1.069), (I-749)+(1.055)+(1.070), (I-749)+(1.055)+(1.071), (I-749)+(1.055)+(1.072), (I-749)+(1.055)+(1.073), (I-749)+(1.055)+(1.074), (I-749)+(1.055)+(1.075), (I-749)+(1.055)+(1.076), (I-749)+(1.055)+(1.077), (I-749)+(1.055)+(1.078), (I-749)+(1.055)+(1.079), (I-749)+(1.055)+(1.080), (I-749)+(1.055)+(1.081), (I-749)+(1.055)+(1.082), (I-749)+(1.055)+(1.083), (I-749)+(1.055)+(1.084), (I-749)+(1.055)+(1.085), (I-749)+(1.055)+(1.086), (I-749)+(1.055)+(1.087), (I-749)+(1.055)+(1.088), (I-749)+(1.055)+(1.089), (I-749)+(1.055)+(1.090), (I-749)+(1.055)+(1.091), (I-749)+(1.055)+(1.092), (I-749)+(1.055)+(2.001), (I-749)+(1.055)+(2.002), (I-749)+(1.055)+(2.003), (I-749)+(1.055)+(2.004), (I-749)+(1.055)+(2.005), (I-749)+(1.055)+(2.006), (I-749)+(1.055)+(2.007), (I-749)+(1.055)+(2.008), (I-749)+(1.055)+(2.009), (I-749)+(1.055)+(2.010), (I-749)+(1.055)+(2.011), (I-749)+(1.055)+(2.012), (I-749)+(1.055)+(2.013), (I-749)+(1.055)+(2.014), (I-749)+(1.055)+(2.015), (I-749)+(1.055)+(2.016), (I-749)+(1.055)+(2.017), (I-749)+(1.055)+(2.018), (I-749)+(1.055)+(2.019), (I-749)+(1.055)+(2.020), (I-749)+(1.055)+(2.021), (I-749)+(1.055)+(2.022), (I-749)+(1.055)+(2.023), (I-749)+(1.055)+(2.024), (I-749)+(1.055)+(2.025), (I-749)+(1.055)+(2.026), (I-749)+(1.055)+(2.027), (I-749)+(1.055)+(2.028), (I-749)+(1.055)+(2.029), (I-749)+(1.055)+(2.030), (I-749)+(1.055)+(2.031), (I-749)+(1.055)+(2.032), (I-749)+(1.055)+(2.033), (I-749)+(1.055)+(2.034), (I-749)+(1.055)+(2.035), (I-749)+(1.055)+(2.036), (I-749)+(1.055)+(2.037), (I-749)+(1.055)+(2.038), (I-749)+(1.055)+(2.039), (I-749)+(1.055)+(2.040), (I-749)+(1.055)+(2.041), (I-749)+(1.055)+(2.042), (I-749)+(1.055)+(2.043), (I-749)+(1.055)+(2.044), (I-749)+(1.055)+(2.045), (I-749)+(1.055)+(2.046), (I-749)+(1.055)+(2.047), (I-749)+(1.055)+(2.048), (I-749)+(1.055)+(2.049), (I-749)+(1.055)+(2.050), (I-749)+(1.055)+(2.051), (I-749)+(1.055)+(2.052), (I-749)+(1.055)+(2.053), (I-749)+(1.055)+(2.054), (I-749)+(1.055)+(2.055), (I-749)+(1.055)+(2.056), (I-749)+(1.055)+(2.057), (I-749)+(1.055)+(2.058), (I-749)+(1.055)+(2.059), (I-749)+(1.055)+(3.001), (I-749)+(1.055)+(3.002), (I-749)+(1.055)+(3.003), (I-749)+(1.055)+(3.004), (I-749)+(1.055)+(3.005), (I-749)+(1.055)+(3.006), (I-749)+(1.055)+(3.007), (I-749)+(1.055)+(3.008), (I-749)+(1.055)+(3.009), (I-749)+(1.055)+(3.010), (I-749)+(1.055)+(3.011), (I-749)+(1.055)+(3.012), (I-749)+(1.055)+(3.013), (I-749)+(1.055)+(3.014), (I-749)+(1.055)+(3.015), (I-749)+(1.055)+(3.016), (I-749)+(1.055)+(3.017), (I-749)+(1.055)+(3.018), (I-749)+(1.055)+(3.019), (I-749)+(1.055)+(3.020), (I-749)+(1.055)+(3.021), (I-749)+(1.055)+(3.022), (I-749)+(1.055)+(3.023), (I-749)+(1.055)+(3.024), (I-749)+(1.055)+(3.025), (I-749)+(1.055)+(3.026), (I-749)+(1.055)+(3.027), (I-749)+(1.055)+(3.028), (I-749)+(1.055)+(3.029), (I-749)+(1.055)+(3.030), (I-749)+(1.055)+(3.031), (I-749)+(1.055)+(5.001), (I-749)+(1.055)+(5.002), (I-749)+(1.055)+(5.003), (I-749)+(1.055)+(5.004), (I-749)+(1.055)+(5.005), (I-749)+(1.055)+(5.006), (I-749)+(1.055)+(5.007), (I-749)+(1.055)+(5.008), (I-749)+(1.055)+(5.009), (I-749)+(1.055)+(5.010), (I-749)+(1.055)+(5.011), (I-749)+(1.055)+(5.012), (I-749)+(1.055)+(5.013), (I-749)+(1.055)+(5.014), (I-749)+(1.055)+(5.015), (I-749)+(1.055)+(5.016), (I-749)+(1.055)+(5.017), (I-749)+(1.055)+(5.018), (I-749)+(1.055)+(5.019), (I-749)+(1.055)+(5.020), (I-749)+(1.055)+(5.021), (I-749)+(1.055)+(5.022), (I-749)+(1.055)+(5.023), (I-749)+(1.055)+(6.001), (I-749)+(1.055)+(6.002), (I-749)+(1.055)+(6.003), (I-749)+(1.055)+(6.004), (I-749)+(1.055)+(7.001), (I-749)+(1.055)+(7.002), (I-749)+(1.055)+(7.003), (I-749)+(1.055)+(7.004), (I-749)+(1.055)+(7.005), (I-749)+(1.055)+(7.006), (I-749)+(1.055)+(9.001), (I-749)+(1.055)+(9.002), (I-749)+(1.055)+(9.003), (I-749)+(1.055)+(9.004), (I-749)+(1.055)+(9.005), (I-749)+(1.055)+(9.006), (I-749)+(1.055)+(9.007), (I-749)+(1.055)+(9.008), (I-749)+(1.055)+(9.009), (I-749)+(1.055)+(14.001), (I-749)+(1.055)+(14.002), (I-749)+(1.055)+(15.008), (I-749)+(1.055)+(15.011), (I-749)+(1.055)+(15.012), (I-749)+(1.055)+(15.016), (I-749)+(1.055)+(15.025), (I-749)+(1.055)+(15.027), (I-749)+(1.055)+(15.047), (I-749)+(1.055)+(15.063), (I-749)+(1.055)+(15.064), (I-749)+(1.055)+(16.001), (I-749)+(1.055)+(16.002), (I-749)+(1.055)+(16.003), (I-749)+(1.055)+(16.004), (I-749)+(1.055)+(16.005), (I-749)+(1.055)+(16.006), (I-749)+(1.055)+(16.007), (I-749)+(1.055)+(16.008), (I-749)+(1.055)+(17.001), (I-749)+(1.055)+(17.002), (I-749)+(1.055)+(17.003), (I-749)+(1.055)+(17.004), (I-749)+(1.055)+(17.005), (I-749)+(1.055)+(17.006), (I-749)+(1.055)+(17.007), (I-749)+(1.055)+(17.008), (I-749)+(1.055)+(17.009), (I-749)+(1.055)+(17.010), (I-749)+(1.055)+(17.011), (I-749)+(1.055)+(17.012), (I-749)+(1.055)+(18.001),

(I-749)+(1.056)+(1.057), (I-749)+(1.056)+(1.058), (I-749)+(1.056)+(1.059), (I-749)+(1.056)+(1.060), (I-749)+(1.056)+(1.061), (I-749)+(1.056)+(1.062), (I-749)+(1.056)+(1.063), (I-749)+(1.056)+(1.064), (I-749)+(1.056)+(1.065), (I-749)+(1.056)+(1.066), (I-749)+(1.056)+(1.067), (I-749)+(1.056)+(1.068), (I-749)+(1.056)+(1.069), (I-749)+(1.056)+(1.070), (I-749)+(1.056)+(1.071), (I-749)+(1.056)+(1.072), (I-749)+(1.056)+(1.073), (I-749)+(1.056)+(1.074), (I-749)+(1.056)+(1.075), (I-749)+(1.056)+(1.076), (I-749)+(1.056)+(1.077), (I-749)+(1.056)+(1.078), (I-749)+(1.056)+(1.079), (I-749)+(1.056)+(1.080), (I-749)+(1.056)+(1.081), (I-749)+(1.056)+(1.082), (I-749)+(1.056)+(1.083), (I-749)+(1.056)+(1.084), (I-749)+(1.056)+(1.085), (I-749)+(1.056)+(1.086), (I-749)+(1.056)+(1.087), (I-749)+(1.056)+(1.088), (I-749)+(1.056)+(1.089), (I-749)+(1.056)+(1.090), (I-749)+(1.056)+(1.091), (I-749)+(1.056)+(1.092), (I-749)+(1.056)+(2.001), (I-749)+(1.056)+(2.002), (I-749)+(1.056)+(2.003), (I-749)+(1.056)+(2.004), (I-749)+(1.056)+(2.005), (I-749)+(1.056)+(2.006), (I-749)+(1.056)+(2.007), (I-749)+(1.056)+(2.008), (I-749)+(1.056)+(2.009), (I-749)+(1.056)+(2.010), (I-749)+(1.056)+(2.011), (I-749)+(1.056)+(2.012), (I-749)+(1.056)+(2.013), (I-749)+(1.056)+(2.014), (I-749)+(1.056)+(2.015), (I-749)+(1.056)+(2.016), (I-749)+(1.056)+(2.017), (I-749)+(1.056)+(2.018), (I-749)+(1.056)+(2.019), (I-749)+(1.056)+(2.020), (I-749)+(1.056)+(2.021), (I-749)+(1.056)+(2.022), (I-749)+(1.056)+(2.023), (I-749)+(1.056)+(2.024), (I-749)+(1.056)+(2.025), (I-749)+(1.056)+(2.026), (I-749)+(1.056)+(2.027), (I-749)+(1.056)+(2.028), (I-749)+(1.056)+(2.029), (I-749)+(1.056)+(2.030), (I-749)+(1.056)+(2.031), (I-749)+(1.056)+(2.032), (I-749)+(1.056)+(2.033), (I-749)+(1.056)+(2.034), (I-749)+(1.056)+(2.035), (I-749)+(1.056)+(2.036), (I-749)+(1.056)+(2.037), (I-749)+(1.056)+(2.038), (I-749)+(1.056)+(2.039), (I-749)+(1.056)+(2.040), (I-749)+(1.056)+(2.041), (I-749)+(1.056)+(2.042), (I-749)+(1.056)+(2.043), (I-749)+(1.056)+(2.044), (I-749)+(1.056)+(2.045), (I-749)+(1.056)+(2.046), (I-749)+(1.056)+(2.047), (I-749)+(1.056)+(2.048), (I-749)+(1.056)+(2.049), (I-749)+(1.056)+(2.050), (I-749)+(1.056)+(2.051), (I-749)+(1.056)+(2.052), (I-749)+(1.056)+(2.053), (I-749)+(1.056)+(2.054), (I-749)+(1.056)+(2.055), (I-749)+(1.056)+(2.056), (I-749)+(1.056)+(2.057), (I-749)+(1.056)+(2.058), (I-749)+(1.056)+(2.059), (I-749)+(1.056)+(3.001), (I-749)+(1.056)+(3.002), (I-749)+(1.056)+(3.003), (I-749)+(1.056)+(3.004), (I-749)+(1.056)+(3.005), (I-749)+(1.056)+(3.006), (I-749)+(1.056)+(3.007), (I-749)+(1.056)+(3.008), (I-749)+(1.056)+(3.009), (I-749)+(1.056)+(3.010), (I-749)+(1.056)+(3.011), (I-749)+(1.056)+(3.012), (I-749)+(1.056)+(3.013), (I-749)+(1.056)+(3.014), (I-749)+(1.056)+(3.015), (I-749)+(1.056)+(3.016), (I-749)+(1.056)+(3.017), (I-749)+(1.056)+(3.018), (I-749)+(1.056)+(3.019), (I-749)+(1.056)+(3.020), (I-749)+(1.056)+(3.021), (I-749)+(1.056)+(3.022), (I-749)+(1.056)+(3.023), (I-749)+(1.056)+(3.024), (I-749)+(1.056)+(3.025), (I-749)+(1.056)+(3.026), (I-749)+(1.056)+(3.027), (I-749)+(1.056)+(3.028), (I-749)+(1.056)+(3.029), (I-749)+(1.056)+(3.030), (I-749)+(1.056)+(3.031), (I-749)+(1.056)+(5.001), (I-749)+(1.056)+(5.002), (I-749)+(1.056)+(5.003), (I-749)+(1.056)+(5.004), (I-749)+(1.056)+(5.005), (I-749)+(1.056)+(5.006), (I-749)+(1.056)+(5.007), (I-749)+(1.056)+(5.008), (I-749)+(1.056)+(5.009), (I-749)+(1.056)+(5.010), (I-749)+(1.056)+(5.011), (I-749)+(1.056)+(5.012), (I-749)+(1.056)+(5.013), (I-749)+(1.056)+(5.014), (I-749)+(1.056)+(5.015), (I-749)+(1.056)+(5.016), (I-749)+(1.056)+(5.017), (I-749)+(1.056)+(5.018), (I-749)+(1.056)+(5.019), (I-749)+(1.056)+(5.020), (I-749)+(1.056)+(5.021), (I-749)+(1.056)+(5.022), (I-749)+(1.056)+(5.023), (I-749)+(1.056)+(6.001), (I-749)+(1.056)+(6.002), (I-749)+(1.056)+(6.003), (I-749)+(1.056)+(6.004), (I-749)+(1.056)+(7.001), (I-749)+(1.056)+(7.002), (I-749)+(1.056)+(7.003), (I-749)+(1.056)+(7.004), (I-749)+(1.056)+(7.005), (I-749)+(1.056)+(7.006), (I-749)+(1.056)+(9.001), (I-749)+(1.056)+(9.002), (I-749)+(1.056)+(9.003), (I-749)+(1.056)+(9.004), (I-749)+(1.056)+(9.005), (I-749)+(1.056)+(9.006), (I-749)+(1.056)+(9.007), (I-749)+(1.056)+(9.008), (I-749)+(1.056)+(9.009), (I-749)+(1.056)+(14.001), (I-749)+(1.056)+(14.002), (I-749)+(1.056)+(15.008), (I-749)+(1.056)+(15.011), (I-749)+(1.056)+(15.012), (I-749)+(1.056)+(15.016), (I-749)+(1.056)+(15.025), (I-749)+(1.056)+(15.027), (I-749)+(1.056)+(15.047), (I-749)+(1.056)+(15.063), (I-749)+(1.056)+(15.064), (I-749)+(1.056)+(16.001), (I-749)+(1.056)+(16.002), (I-749)+(1.056)+(16.003), (I-749)+(1.056)+(16.004), (I-749)+(1.056)+(16.005), (I-749)+(1.056)+(16.006), (I-749)+(1.056)+(16.007), (I-749)+(1.056)+(16.008), (I-749)+(1.056)+(17.001), (I-749)+(1.056)+(17.002), (I-749)+(1.056)+(17.003), (I-749)+(1.056)+(17.004), (I-749)+(1.056)+(17.005), (I-749)+(1.056)+(17.006), (I-749)+(1.056)+(17.007), (I-749)+(1.056)+(17.008), (I-749)+(1.056)+(17.009), (I-749)+(1.056)+(17.010), (I-749)+(1.056)+(17.011), (I-749)+(1.056)+(17.012), (I-749)+(1.056)+(18.001),

(I-749)+(1.057)+(1.058), (I-749)+(1.057)+(1.059), (I-749)+(1.057)+(1.060), (I-749)+(1.057)+(1.061), (I-749)+(1.057)+(1.062), (I-749)+(1.057)+(1.063), (I-749)+(1.057)+(1.064), (I-749)+(1.057)+(1.065), (I-749)+(1.057)+(1.066), (I-749)+(1.057)+(1.067), (I-749)+(1.057)+(1.068), (I-749)+(1.057)+(1.069), (I-749)+(1.057)+(1.070), (I-749)+(1.057)+(1.071), (I-749)+(1.057)+(1.072), (I-749)+(1.057)+(1.073), (I-749)+(1.057)+(1.074), (I-749)+(1.057)+(1.075), (I-749)+(1.057)+(1.076), (I-749)+(1.057)+(1.077), (I-749)+(1.057)+(1.078), (I-749)+(1.057)+(1.079), (I-749)+(1.057)+(1.080), (I-749)+(1.057)+(1.081), (I-749)+(1.057)+(1.082), (I-749)+(1.057)+(1.083), (I-749)+(1.057)+(1.084), (I-749)+(1.057)+(1.085), (I-749)+(1.057)+(1.086), (I-749)+(1.057)+(1.087), (I-749)+(1.057)+(1.088), (I-749)+(1.057)+(1.089), (I-749)+(1.057)+(1.090), (I-749)+(1.057)+(1.091), (I-749)+(1.057)+(1.092), (I-749)+(1.057)+(2.001), (I-749)+(1.057)+(2.002), (I-749)+(1.057)+(2.003), (I-749)+(1.057)+(2.004), (I-749)+(1.057)+(2.005), (I-749)+(1.057)+(2.006), (I-749)+(1.057)+(2.007), (I-749)+(1.057)+(2.008), (I-749)+(1.057)+(2.009), (I-749)+(1.057)+(2.010), (I-749)+(1.057)+(2.011), (I-749)+(1.057)+(2.012), (I-749)+(1.057)+(2.013), (I-749)+(1.057)+(2.014), (I-749)+(1.057)+(2.015), (I-749)+(1.057)+(2.016), (I-749)+(1.057)+(2.017), (I-749)+(1.057)+(2.018), (I-749)+(1.057)+(2.019), (I-749)+(1.057)+(2.020), (I-749)+(1.057)+(2.021), (I-749)+(1.057)+(2.022), (I-749)+(1.057)+(2.023), (I-749)+(1.057)+(2.024), (I-749)+(1.057)+(2.025), (I-749)+(1.057)+(2.026), (I-749)+(1.057)+(2.027), (I-749)+(1.057)+(2.028), (I-749)+(1.057)+(2.029), (I-749)+(1.057)+(2.030), (I-749)+(1.057)+(2.031), (I-749)+(1.057)+(2.032), (I-749)+(1.057)+(2.033), (I-749)+(1.057)+(2.034), (I-749)+(1.057)+(2.035), (I-749)+(1.057)+(2.036), (I-749)+(1.057)+(2.037), (I-749)+(1.057)+(2.038), (I-749)+(1.057)+(2.039), (I-749)+(1.057)+(2.040), (I-749)+(1.057)+(2.041), (I-749)+(1.057)+(2.042), (I-749)+(1.057)+(2.043), (I-749)+(1.057)+(2.044), (I-749)+(1.057)+(2.045), (I-749)+(1.057)+(2.046), (I-749)+(1.057)+(2.047), (I-749)+(1.057)+(2.048), (I-749)+(1.057)+(2.049), (I-749)+(1.057)+(2.050), (I-749)+(1.057)+(2.051), (I-749)+(1.057)+(2.052), (I-749)+(1.057)+(2.053), (I-749)+(1.057)+(2.054), (I-749)+(1.057)+(2.055), (I-749)+(1.057)+(2.056), (I-749)+(1.057)+(2.057), (I-749)+(1.057)+(2.058), (I-749)+(1.057)+(2.059), (I-749)+(1.057)+(3.001), (I-749)+(1.057)+(3.002), (I-749)+(1.057)+(3.003), (I-749)+(1.057)+(3.004), (I-749)+(1.057)+(3.005), (I-749)+(1.057)+(3.006), (I-749)+(1.057)+(3.007), (I-749)+(1.057)+(3.008), (I-749)+(1.057)+(3.009), (I-749)+(1.057)+(3.010), (I-749)+(1.057)+(3.011), (I-749)+(1.057)+(3.012), (I-749)+(1.057)+(3.013), (I-749)+(1.057)+(3.014), (I-749)+(1.057)+(3.015), (I-749)+(1.057)+(3.016), (I-749)+(1.057)+(3.017), (I-749)+(1.057)+(3.018), (I-749)+(1.057)+(3.019), (I-749)+(1.057)+(3.020), (I-749)+(1.057)+(3.021), (I-749)+(1.057)+(3.022), (I-749)+(1.057)+(3.023), (I-749)+(1.057)+(3.024), (I-749)+(1.057)+(3.025), (I-749)+(1.057)+(3.026), (I-749)+(1.057)+(3.027), (I-749)+(1.057)+(3.028), (I-749)+(1.057)+(3.029), (I-749)+(1.057)+(3.030), (I-749)+(1.057)+(3.031), (I-749)+(1.057)+(5.001), (I-749)+(1.057)+(5.002), (I-749)+(1.057)+(5.003), (I-749)+(1.057)+(5.004), (I-749)+(1.057)+(5.005), (I-749)+(1.057)+(5.006), (I-749)+(1.057)+(5.007), (I-749)+(1.057)+(5.008), (I-749)+(1.057)+(5.009), (I-749)+(1.057)+(5.010), (I-749)+(1.057)+(5.011), (I-749)+(1.057)+(5.012), (I-749)+(1.057)+(5.013), (I-749)+(1.057)+(5.014), (I-749)+(1.057)+(5.015), (I-749)+(1.057)+(5.016), (I-749)+(1.057)+(5.017), (I-749)+(1.057)+(5.018), (I-749)+(1.057)+(5.019), (I-749)+(1.057)+(5.020), (I-749)+(1.057)+(5.021), (I-749)+(1.057)+(5.022), (I-749)+(1.057)+(5.023), (I-749)+(1.057)+(6.001), (I-749)+(1.057)+(6.002), (I-749)+(1.057)+(6.003), (I-749)+(1.057)+(6.004), (I-749)+(1.057)+(7.001), (I-749)+(1.057)+(7.002), (I-749)+(1.057)+(7.003), (I-749)+(1.057)+(7.004), (I-749)+(1.057)+(7.005), (I-749)+(1.057)+(7.006), (I-749)+(1.057)+(9.001), (I-749)+(1.057)+(9.002), (I-749)+(1.057)+(9.003), (I-749)+(1.057)+(9.004), (I-749)+(1.057)+(9.005), (I-749)+(1.057)+(9.006), (I-749)+(1.057)+(9.007), (I-749)+(1.057)+(9.008), (I-749)+(1.057)+(9.009), (I-749)+(1.057)+(14.001), (I-749)+(1.057)+(14.002), (I-749)+(1.057)+(15.008), (I-749)+(1.057)+(15.011), (I-749)+(1.057)+(15.012), (I-749)+(1.057)+(15.016), (I-749)+(1.057)+(15.025), (I-749)+(1.057)+(15.027), (I-749)+(1.057)+(15.047), (I-749)+(1.057)+(15.063), (I-749)+(1.057)+(15.064), (I-749)+(1.057)+(16.001), (I-749)+(1.057)+(16.002), (I-749)+(1.057)+(16.003), (I-749)+(1.057)+(16.004), (I-749)+(1.057)+(16.005), (I-749)+(1.057)+(16.006), (I-749)+(1.057)+(16.007), (I-749)+(1.057)+(16.008), (I-749)+(1.057)+(17.001), (I-749)+(1.057)+(17.002), (I-749)+(1.057)+(17.003), (I-749)+(1.057)+(17.004), (I-749)+(1.057)+(17.005), (I-749)+(1.057)+(17.006), (I-749)+(1.057)+(17.007), (I-749)+(1.057)+(17.008), (I-749)+(1.057)+(17.009), (I-749)+(1.057)+(17.010), (I-749)+(1.057)+(17.011), (I-749)+(1.057)+(17.012), (I-749)+(1.057)+(18.001),

(I-749)+(1.058)+(1.059), (I-749)+(1.058)+(1.060), (I-749)+(1.058)+(1.061), (I-749)+(1.058)+(1.062), (I-749)+(1.058)+(1.063), (I-749)+(1.058)+(1.064), (I-749)+(1.058)+(1.065), (I-749)+(1.058)+(1.066), (I-749)+(1.058)+(1.067), (I-749)+(1.058)+(1.068), (I-749)+(1.058)+(1.069), (I-749)+(1.058)+(1.070), (I-749)+(1.058)+(1.071), (I-749)+(1.058)+(1.072), (I-749)+(1.058)+(1.073), (I-749)+(1.058)+(1.074), (I-749)+(1.058)+(1.075), (I-749)+(1.058)+(1.076), (I-749)+(1.058)+(1.077), (I-749)+(1.058)+(1.078), (I-749)+(1.058)+(1.079), (I-749)+(1.058)+(1.080), (I-749)+(1.058)+(1.081), (I-749)+(1.058)+(1.082), (I-749)+(1.058)+(1.083), (I-749)+(1.058)+(1.084), (I-749)+(1.058)+(1.085), (I-749)+(1.058)+(1.086), (I-749)+(1.058)+(1.087), (I-749)+(1.058)+(1.088), (I-749)+(1.058)+(1.089), (I-749)+(1.058)+(1.090), (I-749)+(1.058)+(1.091), (I-749)+(1.058)+(1.092), (I-749)+(1.058)+(2.001), (I-749)+(1.058)+(2.002), (I-749)+(1.058)+(2.003), (I-749)+(1.058)+(2.004), (I-749)+(1.058)+(2.005), (I-749)+(1.058)+(2.006), (I-749)+(1.058)+(2.007), (I-749)+(1.058)+(2.008), (I-749)+(1.058)+(2.009), (I-749)+(1.058)+(2.010), (I-749)+(1.058)+(2.011), (I-749)+(1.058)+(2.012), (I-749)+(1.058)+(2.013), (I-749)+(1.058)+(2.014), (I-749)+(1.058)+(2.015), (I-749)+(1.058)+(2.016), (I-749)+(1.058)+(2.017), (I-749)+(1.058)+(2.018), (I-749)+(1.058)+(2.019), (I-749)+(1.058)+(2.020), (I-749)+(1.058)+(2.021), (I-749)+(1.058)+(2.022), (I-749)+(1.058)+(2.023), (I-749)+(1.058)+(2.024), (I-749)+(1.058)+(2.025), (I-749)+(1.058)+(2.026), (I-749)+(1.058)+(2.027), (I-749)+(1.058)+(2.028), (I-749)+(1.058)+(2.029), (I-749)+(1.058)+(2.030), (I-749)+(1.058)+(2.031), (I-749)+(1.058)+(2.032), (I-749)+(1.058)+(2.033), (I-749)+(1.058)+(2.034), (I-749)+(1.058)+(2.035), (I-749)+(1.058)+(2.036), (I-749)+(1.058)+(2.037), (I-749)+(1.058)+(2.038), (I-749)+(1.058)+(2.039), (I-749)+(1.058)+(2.040), (I-749)+(1.058)+(2.041), (I-749)+(1.058)+(2.042), (I-749)+(1.058)+(2.043), (I-749)+(1.058)+(2.044), (I-749)+(1.058)+(2.045), (I-749)+(1.058)+(2.046), (I-749)+(1.058)+(2.047), (I-749)+(1.058)+(2.048), (I-749)+(1.058)+(2.049), (I-749)+(1.058)+(2.050), (I-749)+(1.058)+(2.051), (I-749)+(1.058)+(2.052), (I-749)+(1.058)+(2.053), (I-749)+(1.058)+(2.054), (I-749)+(1.058)+(2.055), (I-749)+(1.058)+(2.056), (I-749)+(1.058)+(2.057), (I-749)+(1.058)+(2.058), (I-749)+(1.058)+(2.059), (I-749)+(1.058)+(3.001), (I-749)+(1.058)+(3.002), (I-749)+(1.058)+(3.003), (I-749)+(1.058)+(3.004), (I-749)+(1.058)+(3.005), (I-749)+(1.058)+(3.006), (I-749)+(1.058)+(3.007), (I-749)+(1.058)+(3.008), (I-749)+(1.058)+(3.009), (I-749)+(1.058)+(3.010), (I-749)+(1.058)+(3.011), (I-749)+(1.058)+(3.012), (I-749)+(1.058)+(3.013), (I-749)+(1.058)+(3.014), (I-749)+(1.058)+(3.015), (I-749)+(1.058)+(3.016), (I-749)+(1.058)+(3.017), (I-749)+(1.058)+(3.018), (I-749)+(1.058)+(3.019), (I-749)+(1.058)+(3.020), (I-749)+(1.058)+(3.021), (I-749)+(1.058)+(3.022), (I-749)+(1.058)+(3.023), (I-749)+(1.058)+(3.024), (I-749)+(1.058)+(3.025), (I-749)+(1.058)+(3.026), (I-749)+(1.058)+(3.027), (I-749)+(1.058)+(3.028), (I-749)+(1.058)+(3.029), (I-749)+(1.058)+(3.030), (I-749)+(1.058)+(3.031), (I-749)+(1.058)+(5.001), (I-749)+(1.058)+(5.002), (I-749)+(1.058)+(5.003), (I-749)+(1.058)+(5.004), (I-749)+(1.058)+(5.005), (I-749)+(1.058)+(5.006), (I-749)+(1.058)+(5.007), (I-749)+(1.058)+(5.008), (I-749)+(1.058)+(5.009), (I-749)+(1.058)+(5.010), (I-749)+(1.058)+(5.011), (I-749)+(1.058)+(5.012), (I-749)+(1.058)+(5.013), (I-749)+(1.058)+(5.014), (I-749)+(1.058)+(5.015), (I-749)+(1.058)+(5.016), (I-749)+(1.058)+(5.017), (I-749)+(1.058)+(5.018), (I-749)+(1.058)+(5.019), (I-749)+(1.058)+(5.020), (I-749)+(1.058)+(5.021), (I-749)+(1.058)+(5.022), (I-749)+(1.058)+(5.023), (I-749)+(1.058)+(6.001), (I-749)+(1.058)+(6.002), (I-749)+(1.058)+(6.003), (I-749)+(1.058)+(6.004), (I-749)+(1.058)+(7.001), (I-749)+(1.058)+(7.002), (I-749)+(1.058)+(7.003), (I-749)+(1.058)+(7.004), (I-749)+(1.058)+(7.005), (I-749)+(1.058)+(7.006), (I-749)+(1.058)+(9.001), (I-749)+(1.058)+(9.002), (I-749)+(1.058)+(9.003), (I-749)+(1.058)+(9.004), (I-749)+(1.058)+(9.005), (I-749)+(1.058)+(9.006), (I-749)+(1.058)+(9.007), (I-749)+(1.058)+(9.008), (I-749)+(1.058)+(9.009), (I-749)+(1.058)+(14.001), (I-749)+(1.058)+(14.002), (I-749)+(1.058)+(15.008), (I-749)+(1.058)+(15.011), (I-749)+(1.058)+(15.012), (I-749)+(1.058)+(15.016), (I-749)+(1.058)+(15.025), (I-749)+(1.058)+(15.027), (I-749)+(1.058)+(15.047), (I-749)+(1.058)+(15.063), (I-749)+(1.058)+(15.064), (I-749)+(1.058)+(16.001), (I-749)+(1.058)+(16.002), (I-749)+(1.058)+(16.003), (I-749)+(1.058)+(16.004), (I-749)+(1.058)+(16.005), (I-749)+(1.058)+(16.006), (I-749)+(1.058)+(16.007), (I-749)+(1.058)+(16.008), (I-749)+(1.058)+(17.001), (I-749)+(1.058)+(17.002), (I-749)+(1.058)+(17.003), (I-749)+(1.058)+(17.004), (I-749)+(1.058)+(17.005), (I-749)+(1.058)+(17.006), (I-749)+(1.058)+(17.007), (I-749)+(1.058)+(17.008), (I-749)+(1.058)+(17.009), (I-749)+(1.058)+(17.010), (I-749)+(1.058)+(17.011), (I-749)+(1.058)+(17.012), (I-749)+(1.058)+(18.001),

(I-749)+(1.059)+(1.060), (I-749)+(1.059)+(1.061), (I-749)+(1.059)+(1.062), (I-749)+(1.059)+(1.063), (I-749)+(1.059)+(1.064), (I-749)+(1.059)+(1.065), (I-749)+(1.059)+(1.066), (I-749)+(1.059)+(1.067), (I-749)+(1.059)+(1.068), (I-749)+(1.059)+(1.069), (I-749)+(1.059)+(1.070), (I-749)+(1.059)+(1.071), (I-749)+(1.059)+(1.072), (I-749)+(1.059)+(1.073), (I-749)+(1.059)+(1.074), (I-749)+(1.059)+(1.075), (I-749)+(1.059)+(1.076), (I-749)+(1.059)+(1.077), (I-749)+(1.059)+(1.078), (I-749)+(1.059)+(1.079), (I-749)+(1.059)+(1.080), (I-749)+(1.059)+(1.081), (I-749)+(1.059)+(1.082), (I-749)+(1.059)+(1.083), (I-749)+(1.059)+(1.084), (I-749)+(1.059)+(1.085), (I-749)+(1.059)+(1.086), (I-749)+(1.059)+(1.087), (I-749)+(1.059)+(1.088), (I-749)+(1.059)+(1.089), (I-749)+(1.059)+(1.090), (I-749)+(1.059)+(1.091), (I-749)+(1.059)+(1.092), (I-749)+(1.059)+(2.001), (I-749)+(1.059)+(2.002), (I-749)+(1.059)+(2.003), (I-749)+(1.059)+(2.004), (I-749)+(1.059)+(2.005), (I-749)+(1.059)+(2.006), (I-749)+(1.059)+(2.007), (I-749)+(1.059)+(2.008), (I-749)+(1.059)+(2.009), (I-749)+(1.059)+(2.010), (I-749)+(1.059)+(2.011), (I-749)+(1.059)+(2.012), (I-749)+(1.059)+(2.013), (I-749)+(1.059)+(2.014), (I-749)+(1.059)+(2.015), (I-749)+(1.059)+(2.016), (I-749)+(1.059)+(2.017), (I-749)+(1.059)+(2.018), (I-749)+(1.059)+(2.019), (I-749)+(1.059)+(2.020), (I-749)+(1.059)+(2.021), (I-749)+(1.059)+(2.022), (I-749)+(1.059)+(2.023), (I-749)+(1.059)+(2.024), (I-749)+(1.059)+(2.025), (I-749)+(1.059)+(2.026), (I-749)+(1.059)+(2.027), (I-749)+(1.059)+(2.028), (I-749)+(1.059)+(2.029), (I-749)+(1.059)+(2.030), (I-749)+(1.059)+(2.031), (I-749)+(1.059)+(2.032), (I-749)+(1.059)+(2.033), (I-749)+(1.059)+(2.034), (I-749)+(1.059)+(2.035), (I-749)+(1.059)+(2.036), (I-749)+(1.059)+(2.037), (I-749)+(1.059)+(2.038), (I-749)+(1.059)+(2.039), (I-749)+(1.059)+(2.040), (I-749)+(1.059)+(2.041), (I-749)+(1.059)+(2.042), (I-749)+(1.059)+(2.043), (I-749)+(1.059)+(2.044), (I-749)+(1.059)+(2.045), (I-749)+(1.059)+(2.046), (I-749)+(1.059)+(2.047), (I-749)+(1.059)+(2.048), (I-749)+(1.059)+(2.049), (I-749)+(1.059)+(2.050), (I-749)+(1.059)+(2.051), (I-749)+(1.059)+(2.052), (I-749)+(1.059)+(2.053), (I-749)+(1.059)+(2.054), (I-749)+(1.059)+(2.055), (I-749)+(1.059)+(2.056), (I-749)+(1.059)+(2.057), (I-749)+(1.059)+(2.058), (I-749)+(1.059)+(2.059), (I-749)+(1.059)+(3.001), (I-749)+(1.059)+(3.002), (I-749)+(1.059)+(3.003), (I-749)+(1.059)+(3.004), (I-749)+(1.059)+(3.005), (I-749)+(1.059)+(3.006), (I-749)+(1.059)+(3.007), (I-749)+(1.059)+(3.008), (I-749)+(1.059)+(3.009), (I-749)+(1.059)+(3.010), (I-749)+(1.059)+(3.011), (I-749)+(1.059)+(3.012), (I-749)+(1.059)+(3.013), (I-749)+(1.059)+(3.014), (I-749)+(1.059)+(3.015), (I-749)+(1.059)+(3.016), (I-749)+(1.059)+(3.017), (I-749)+(1.059)+(3.018), (I-749)+(1.059)+(3.019), (I-749)+(1.059)+(3.020), (I-749)+(1.059)+(3.021), (I-749)+(1.059)+(3.022), (I-749)+(1.059)+(3.023), (I-749)+(1.059)+(3.024), (I-749)+(1.059)+(3.025), (I-749)+(1.059)+(3.026), (I-749)+(1.059)+(3.027), (I-749)+(1.059)+(3.028), (I-749)+(1.059)+(3.029), (I-749)+(1.059)+(3.030), (I-749)+(1.059)+(3.031), (I-749)+(1.059)+(5.001), (I-749)+(1.059)+(5.002), (I-749)+(1.059)+(5.003), (I-749)+(1.059)+(5.004), (I-749)+(1.059)+(5.005), (I-749)+(1.059)+(5.006), (I-749)+(1.059)+(5.007), (I-749)+(1.059)+(5.008), (I-749)+(1.059)+(5.009), (I-749)+(1.059)+(5.010), (I-749)+(1.059)+(5.011), (I-749)+(1.059)+(5.012), (I-749)+(1.059)+(5.013), (I-749)+(1.059)+(5.014), (I-749)+(1.059)+(5.015), (I-749)+(1.059)+(5.016), (I-749)+(1.059)+(5.017), (I-749)+(1.059)+(5.018), (I-749)+(1.059)+(5.019), (I-749)+(1.059)+(5.020), (I-749)+(1.059)+(5.021), (I-749)+(1.059)+(5.022), (I-749)+(1.059)+(5.023), (I-749)+(1.059)+(6.001), (I-749)+(1.059)+(6.002), (I-749)+(1.059)+(6.003), (I-749)+(1.059)+(6.004), (I-749)+(1.059)+(7.001), (I-749)+(1.059)+(7.002), (I-749)+(1.059)+(7.003), (I-749)+(1.059)+(7.004), (I-749)+(1.059)+(7.005), (I-749)+(1.059)+(7.006), (I-749)+(1.059)+(9.001), (I-749)+(1.059)+(9.002), (I-749)+(1.059)+(9.003), (I-749)+(1.059)+(9.004), (I-749)+(1.059)+(9.005), (I-749)+(1.059)+(9.006), (I-749)+(1.059)+(9.007), (I-749)+(1.059)+(9.008), (I-749)+(1.059)+(9.009), (I-749)+(1.059)+(14.001), (I-749)+(1.059)+(14.002), (I-749)+(1.059)+(15.008), (I-749)+(1.059)+(15.011), (I-749)+(1.059)+(15.012), (I-749)+(1.059)+(15.016), (I-749)+(1.059)+(15.025), (I-749)+(1.059)+(15.027), (I-749)+(1.059)+(15.047), (I-749)+(1.059)+(15.063), (I-749)+(1.059)+(15.064), (I-749)+(1.059)+(16.001), (I-749)+(1.059)+(16.002), (I-749)+(1.059)+(16.003), (I-749)+(1.059)+(16.004), (I-749)+(1.059)+(16.005), (I-749)+(1.059)+(16.006), (I-749)+(1.059)+(16.007), (I-749)+(1.059)+(16.008), (I-749)+(1.059)+(17.001), (I-749)+(1.059)+(17.002), (I-749)+(1.059)+(17.003), (I-749)+(1.059)+(17.004), (I-749)+(1.059)+(17.005), (I-749)+(1.059)+(17.006), (I-749)+(1.059)+(17.007), (I-749)+(1.059)+(17.008), (I-749)+(1.059)+(17.009), (I-749)+(1.059)+(17.010), (I-749)+(1.059)+(17.011), (I-749)+(1.059)+(17.012), (I-749)+(1.059)+(18.001),

(I-749)+(1.060)+(1.061), (I-749)+(1.060)+(1.062), (I-749)+(1.060)+(1.063), (I-749)+(1.060)+(1.064), (I-749)+(1.060)+(1.065), (I-749)+(1.060)+(1.066), (I-749)+(1.060)+(1.067), (I-749)+(1.060)+(1.068), (I-749)+(1.060)+(1.069), (I-749)+(1.060)+(1.070), (I-749)+(1.060)+(1.071), (I-749)+(1.060)+(1.072), (I-749)+(1.060)+(1.073), (I-749)+(1.060)+(1.074), (I-749)+(1.060)+(1.075), (I-749)+(1.060)+(1.076), (I-749)+(1.060)+(1.077), (I-749)+(1.060)+(1.078), (I-749)+(1.060)+(1.079), (I-749)+(1.060)+(1.080), (I-749)+(1.060)+(1.081), (I-749)+(1.060)+(1.082), (I-749)+(1.060)+(1.083), (I-749)+(1.060)+(1.084), (I-749)+(1.060)+(1.085), (I-749)+(1.060)+(1.086), (I-749)+(1.060)+(1.087), (I-749)+(1.060)+(1.088), (I-749)+(1.060)+(1.089), (I-749)+(1.060)+(1.090), (I-749)+(1.060)+(1.091), (I-749)+(1.060)+(1.092), (I-749)+(1.060)+(2.001), (I-749)+(1.060)+(2.002), (I-749)+(1.060)+(2.003), (I-749)+(1.060)+(2.004), (I-749)+(1.060)+(2.005), (I-749)+(1.060)+(2.006), (I-749)+(1.060)+(2.007), (I-749)+(1.060)+(2.008), (I-749)+(1.060)+(2.009), (I-749)+(1.060)+(2.010), (I-749)+(1.060)+(2.011), (I-749)+(1.060)+(2.012), (I-749)+(1.060)+(2.013), (I-749)+(1.060)+(2.014), (I-749)+(1.060)+(2.015), (I-749)+(1.060)+(2.016), (I-749)+(1.060)+(2.017), (I-749)+(1.060)+(2.018), (I-749)+(1.060)+(2.019), (I-749)+(1.060)+(2.020), (I-749)+(1.060)+(2.021), (I-749)+(1.060)+(2.022), (I-749)+(1.060)+(2.023), (I-749)+(1.060)+(2.024), (I-749)+(1.060)+(2.025), (I-749)+(1.060)+(2.026), (I-749)+(1.060)+(2.027), (I-749)+(1.060)+(2.028), (I-749)+(1.060)+(2.029), (I-749)+(1.060)+(2.030), (I-749)+(1.060)+(2.031), (I-749)+(1.060)+(2.032), (I-749)+(1.060)+(2.033), (I-749)+(1.060)+(2.034), (I-749)+(1.060)+(2.035), (I-749)+(1.060)+(2.036), (I-749)+(1.060)+(2.037), (I-749)+(1.060)+(2.038), (I-749)+(1.060)+(2.039), (I-749)+(1.060)+(2.040), (I-749)+(1.060)+(2.041), (I-749)+(1.060)+(2.042), (I-749)+(1.060)+(2.043), (I-749)+(1.060)+(2.044), (I-749)+(1.060)+(2.045), (I-749)+(1.060)+(2.046), (I-749)+(1.060)+(2.047), (I-749)+(1.060)+(2.048), (I-749)+(1.060)+(2.049), (I-749)+(1.060)+(2.050), (I-749)+(1.060)+(2.051), (I-749)+(1.060)+(2.052), (I-749)+(1.060)+(2.053), (I-749)+(1.060)+(2.054), (I-749)+(1.060)+(2.055), (I-749)+(1.060)+(2.056), (I-749)+(1.060)+(2.057), (I-749)+(1.060)+(2.058), (I-749)+(1.060)+(2.059), (I-749)+(1.060)+(3.001), (I-749)+(1.060)+(3.002), (I-749)+(1.060)+(3.003), (I-749)+(1.060)+(3.004), (I-749)+(1.060)+(3.005), (I-749)+(1.060)+(3.006), (I-749)+(1.060)+(3.007), (I-749)+(1.060)+(3.008), (I-749)+(1.060)+(3.009), (I-749)+(1.060)+(3.010), (I-749)+(1.060)+(3.011), (I-749)+(1.060)+(3.012), (I-749)+(1.060)+(3.013), (I-749)+(1.060)+(3.014), (I-749)+(1.060)+(3.015), (I-749)+(1.060)+(3.016), (I-749)+(1.060)+(3.017), (I-749)+(1.060)+(3.018), (I-749)+(1.060)+(3.019), (I-749)+(1.060)+(3.020), (I-749)+(1.060)+(3.021), (I-749)+(1.060)+(3.022), (I-749)+(1.060)+(3.023), (I-749)+(1.060)+(3.024), (I-749)+(1.060)+(3.025), (I-749)+(1.060)+(3.026), (I-749)+(1.060)+(3.027), (I-749)+(1.060)+(3.028), (I-749)+(1.060)+(3.029), (I-749)+(1.060)+(3.030), (I-749)+(1.060)+(3.031), (I-749)+(1.060)+(5.001), (I-749)+(1.060)+(5.002), (I-749)+(1.060)+(5.003), (I-749)+(1.060)+(5.004), (I-749)+(1.060)+(5.005), (I-749)+(1.060)+(5.006), (I-749)+(1.060)+(5.007), (I-749)+(1.060)+(5.008), (I-749)+(1.060)+(5.009), (I-749)+(1.060)+(5.010), (I-749)+(1.060)+(5.011), (I-749)+(1.060)+(5.012), (I-749)+(1.060)+(5.013), (I-749)+(1.060)+(5.014), (I-749)+(1.060)+(5.015), (I-749)+(1.060)+(5.016), (I-749)+(1.060)+(5.017), (I-749)+(1.060)+(5.018), (I-749)+(1.060)+(5.019), (I-749)+(1.060)+(5.020), (I-749)+(1.060)+(5.021), (I-749)+(1.060)+(5.022), (I-749)+(1.060)+(5.023), (I-749)+(1.060)+(6.001), (I-749)+(1.060)+(6.002), (I-749)+(1.060)+(6.003), (I-749)+(1.060)+(6.004), (I-749)+(1.060)+(7.001), (I-749)+(1.060)+(7.002), (I-749)+(1.060)+(7.003), (I-749)+(1.060)+(7.004), (I-749)+(1.060)+(7.005), (I-749)+(1.060)+(7.006), (I-749)+(1.060)+(9.001), (I-749)+(1.060)+(9.002), (I-749)+(1.060)+(9.003), (I-749)+(1.060)+(9.004), (I-749)+(1.060)+(9.005), (I-749)+(1.060)+(9.006), (I-749)+(1.060)+(9.007), (I-749)+(1.060)+(9.008), (I-749)+(1.060)+(9.009), (I-749)+(1.060)+(14.001), (I-749)+(1.060)+(14.002), (I-749)+(1.060)+(15.008), (I-749)+(1.060)+(15.011), (I-749)+(1.060)+(15.012), (I-749)+(1.060)+(15.016), (I-749)+(1.060)+(15.025), (I-749)+(1.060)+(15.027), (I-749)+(1.060)+(15.047), (I-749)+(1.060)+(15.063), (I-749)+(1.060)+(15.064), (I-749)+(1.060)+(16.001), (I-749)+(1.060)+(16.002), (I-749)+(1.060)+(16.003), (I-749)+(1.060)+(16.004), (I-749)+(1.060)+(16.005), (I-749)+(1.060)+(16.006), (I-749)+(1.060)+(16.007), (I-749)+(1.060)+(16.008), (I-749)+(1.060)+(17.001), (I-749)+(1.060)+(17.002), (I-749)+(1.060)+(17.003), (I-749)+(1.060)+(17.004), (I-749)+(1.060)+(17.005), (I-749)+(1.060)+(17.006), (I-749)+(1.060)+(17.007), (I-749)+(1.060)+(17.008), (I-749)+(1.060)+(17.009), (I-749)+(1.060)+(17.010), (I-749)+(1.060)+(17.011), (I-749)+(1.060)+(17.012), (I-749)+(1.060)+(18.001),

(I-749)+(1.061)+(1.062), (I-749)+(1.061)+(1.063), (I-749)+(1.061)+(1.064), (I-749)+(1.061)+(1.065), (I-749)+(1.061)+(1.066), (I-749)+(1.061)+(1.067), (I-749)+(1.061)+(1.068), (I-749)+(1.061)+(1.069), (I-749)+(1.061)+(1.070), (I-749)+(1.061)+(1.071), (I-749)+(1.061)+(1.072), (I-749)+(1.061)+(1.073), (I-749)+(1.061)+(1.074), (I-749)+(1.061)+(1.075), (I-749)+(1.061)+(1.076), (I-749)+(1.061)+(1.077), (I-749)+(1.061)+(1.078), (I-749)+(1.061)+(1.079), (I-749)+(1.061)+(1.080), (I-749)+(1.061)+(1.081), (I-749)+(1.061)+(1.082), (I-749)+(1.061)+(1.083), (I-749)+(1.061)+(1.084), (I-749)+(1.061)+(1.085), (I-749)+(1.061)+(1.086), (I-749)+(1.061)+(1.087), (I-749)+(1.061)+(1.088), (I-749)+(1.061)+(1.089), (I-749)+(1.061)+(1.090), (I-749)+(1.061)+(1.091), (I-749)+(1.061)+(1.092), (I-749)+(1.061)+(2.001), (I-749)+(1.061)+(2.002), (I-749)+(1.061)+(2.003), (I-749)+(1.061)+(2.004), (I-749)+(1.061)+(2.005), (I-749)+(1.061)+(2.006), (I-749)+(1.061)+(2.007), (I-749)+(1.061)+(2.008), (I-749)+(1.061)+(2.009), (I-749)+(1.061)+(2.010), (I-749)+(1.061)+(2.011), (I-749)+(1.061)+(2.012), (I-749)+(1.061)+(2.013), (I-749)+(1.061)+(2.014), (I-749)+(1.061)+(2.015), (I-749)+(1.061)+(2.016), (I-749)+(1.061)+(2.017), (I-749)+(1.061)+(2.018), (I-749)+(1.061)+(2.019), (I-749)+(1.061)+(2.020), (I-749)+(1.061)+(2.021), (I-749)+(1.061)+(2.022), (I-749)+(1.061)+(2.023), (I-749)+(1.061)+(2.024), (I-749)+(1.061)+(2.025), (I-749)+(1.061)+(2.026), (I-749)+(1.061)+(2.027), (I-749)+(1.061)+(2.028), (I-749)+(1.061)+(2.029), (I-749)+(1.061)+(2.030), (I-749)+(1.061)+(2.031), (I-749)+(1.061)+(2.032), (I-749)+(1.061)+(2.033), (I-749)+(1.061)+(2.034), (I-749)+(1.061)+(2.035), (I-749)+(1.061)+(2.036), (I-749)+(1.061)+(2.037), (I-749)+(1.061)+(2.038), (I-749)+(1.061)+(2.039), (I-749)+(1.061)+(2.040), (I-749)+(1.061)+(2.041), (I-749)+(1.061)+(2.042), (I-749)+(1.061)+(2.043), (I-749)+(1.061)+(2.044), (I-749)+(1.061)+(2.045), (I-749)+(1.061)+(2.046), (I-749)+(1.061)+(2.047), (I-749)+(1.061)+(2.048), (I-749)+(1.061)+(2.049), (I-749)+(1.061)+(2.050), (I-749)+(1.061)+(2.051), (I-749)+(1.061)+(2.052), (I-749)+(1.061)+(2.053), (I-749)+(1.061)+(2.054), (I-749)+(1.061)+(2.055), (I-749)+(1.061)+(2.056), (I-749)+(1.061)+(2.057), (I-749)+(1.061)+(2.058), (I-749)+(1.061)+(2.059), (I-749)+(1.061)+(3.001), (I-749)+(1.061)+(3.002), (I-749)+(1.061)+(3.003), (I-749)+(1.061)+(3.004), (I-749)+(1.061)+(3.005), (I-749)+(1.061)+(3.006), (I-749)+(1.061)+(3.007), (I-749)+(1.061)+(3.008), (I-749)+(1.061)+(3.009), (I-749)+(1.061)+(3.010), (I-749)+(1.061)+(3.011), (I-749)+(1.061)+(3.012), (I-749)+(1.061)+(3.013), (I-749)+(1.061)+(3.014), (I-749)+(1.061)+(3.015), (I-749)+(1.061)+(3.016), (I-749)+(1.061)+(3.017), (I-749)+(1.061)+(3.018), (I-749)+(1.061)+(3.019), (I-749)+(1.061)+(3.020), (I-749)+(1.061)+(3.021), (I-749)+(1.061)+(3.022), (I-749)+(1.061)+(3.023), (I-749)+(1.061)+(3.024), (I-749)+(1.061)+(3.025), (I-749)+(1.061)+(3.026), (I-749)+(1.061)+(3.027), (I-749)+(1.061)+(3.028), (I-749)+(1.061)+(3.029), (I-749)+(1.061)+(3.030), (I-749)+(1.061)+(3.031), (I-749)+(1.061)+(5.001), (I-749)+(1.061)+(5.002), (I-749)+(1.061)+(5.003), (I-749)+(1.061)+(5.004), (I-749)+(1.061)+(5.005), (I-749)+(1.061)+(5.006), (I-749)+(1.061)+(5.007), (I-749)+(1.061)+(5.008), (I-749)+(1.061)+(5.009), (I-749)+(1.061)+(5.010), (I-749)+(1.061)+(5.011), (I-749)+(1.061)+(5.012), (I-749)+(1.061)+(5.013), (I-749)+(1.061)+(5.014), (I-749)+(1.061)+(5.015), (I-749)+(1.061)+(5.016), (I-749)+(1.061)+(5.017), (I-749)+(1.061)+(5.018), (I-749)+(1.061)+(5.019), (I-749)+(1.061)+(5.020), (I-749)+(1.061)+(5.021), (I-749)+(1.061)+(5.022), (I-749)+(1.061)+(5.023), (I-749)+(1.061)+(6.001), (I-749)+(1.061)+(6.002), (I-749)+(1.061)+(6.003), (I-749)+(1.061)+(6.004), (I-749)+(1.061)+(7.001), (I-749)+(1.061)+(7.002), (I-749)+(1.061)+(7.003), (I-749)+(1.061)+(7.004), (I-749)+(1.061)+(7.005), (I-749)+(1.061)+(7.006), (I-749)+(1.061)+(9.001), (I-749)+(1.061)+(9.002), (I-749)+(1.061)+(9.003), (I-749)+(1.061)+(9.004), (I-749)+(1.061)+(9.005), (I-749)+(1.061)+(9.006), (I-749)+(1.061)+(9.007), (I-749)+(1.061)+(9.008), (I-749)+(1.061)+(9.009), (I-749)+(1.061)+(14.001), (I-749)+(1.061)+(14.002), (I-749)+(1.061)+(15.008), (I-749)+(1.061)+(15.011), (I-749)+(1.061)+(15.012), (I-749)+(1.061)+(15.016), (I-749)+(1.061)+(15.025), (I-749)+(1.061)+(15.027), (I-749)+(1.061)+(15.047), (I-749)+(1.061)+(15.063), (I-749)+(1.061)+(15.064), (I-749)+(1.061)+(16.001), (I-749)+(1.061)+(16.002), (I-749)+(1.061)+(16.003), (I-749)+(1.061)+(16.004), (I-749)+(1.061)+(16.005), (I-749)+(1.061)+(16.006), (I-749)+(1.061)+(16.007), (I-749)+(1.061)+(16.008), (I-749)+(1.061)+(17.001), (I-749)+(1.061)+(17.002), (I-749)+(1.061)+(17.003), (I-749)+(1.061)+(17.004), (I-749)+(1.061)+(17.005), (I-749)+(1.061)+(17.006), (I-749)+(1.061)+(17.007), (I-749)+(1.061)+(17.008), (I-749)+(1.061)+(17.009), (I-749)+(1.061)+(17.010), (I-749)+(1.061)+(17.011), (I-749)+(1.061)+(17.012), (I-749)+(1.061)+(18.001),

(I-749)+(1.062)+(1.063), (I-749)+(1.062)+(1.064), (I-749)+(1.062)+(1.065), (I-749)+(1.062)+(1.066), (I-749)+(1.062)+(1.067), (I-749)+(1.062)+(1.068), (I-749)+(1.062)+(1.069), (I-749)+(1.062)+(1.070), (I-749)+(1.062)+(1.071), (I-749)+(1.062)+(1.072), (I-749)+(1.062)+(1.073), (I-749)+(1.062)+(1.074), (I-749)+(1.062)+(1.075), (I-749)+(1.062)+(1.076), (I-749)+(1.062)+(1.077), (I-749)+(1.062)+(1.078), (I-749)+(1.062)+(1.079), (I-749)+(1.062)+(1.080), (I-749)+(1.062)+(1.081), (I-749)+(1.062)+(1.082), (I-749)+(1.062)+(1.083), (I-749)+(1.062)+(1.084), (I-749)+(1.062)+(1.085), (I-749)+(1.062)+(1.086), (I-749)+(1.062)+(1.087), (I-749)+(1.062)+(1.088), (I-749)+(1.062)+(1.089), (I-749)+(1.062)+(1.090), (I-749)+(1.062)+(1.091), (I-749)+(1.062)+(1.092), (I-749)+(1.062)+(2.001), (I-749)+(1.062)+(2.002), (I-749)+(1.062)+(2.003), (I-749)+(1.062)+(2.004), (I-749)+(1.062)+(2.005), (I-749)+(1.062)+(2.006), (I-749)+(1.062)+(2.007), (I-749)+(1.062)+(2.008), (I-749)+(1.062)+(2.009), (I-749)+(1.062)+(2.010), (I-749)+(1.062)+(2.011), (I-749)+(1.062)+(2.012), (I-749)+(1.062)+(2.013), (I-749)+(1.062)+(2.014), (I-749)+(1.062)+(2.015), (I-749)+(1.062)+(2.016), (I-749)+(1.062)+(2.017), (I-749)+(1.062)+(2.018), (I-749)+(1.062)+(2.019), (I-749)+(1.062)+(2.020), (I-749)+(1.062)+(2.021), (I-749)+(1.062)+(2.022), (I-749)+(1.062)+(2.023), (I-749)+(1.062)+(2.024), (I-749)+(1.062)+(2.025), (I-749)+(1.062)+(2.026), (I-749)+(1.062)+(2.027), (I-749)+(1.062)+(2.028), (I-749)+(1.062)+(2.029), (I-749)+(1.062)+(2.030), (I-749)+(1.062)+(2.031), (I-749)+(1.062)+(2.032), (I-749)+(1.062)+(2.033), (I-749)+(1.062)+(2.034), (I-749)+(1.062)+(2.035), (I-749)+(1.062)+(2.036), (I-749)+(1.062)+(2.037), (I-749)+(1.062)+(2.038), (I-749)+(1.062)+(2.039), (I-749)+(1.062)+(2.040), (I-749)+(1.062)+(2.041), (I-749)+(1.062)+(2.042), (I-749)+(1.062)+(2.043), (I-749)+(1.062)+(2.044), (I-749)+(1.062)+(2.045), (I-749)+(1.062)+(2.046), (I-749)+(1.062)+(2.047), (I-749)+(1.062)+(2.048), (I-749)+(1.062)+(2.049), (I-749)+(1.062)+(2.050), (I-749)+(1.062)+(2.051), (I-749)+(1.062)+(2.052), (I-749)+(1.062)+(2.053), (I-749)+(1.062)+(2.054), (I-749)+(1.062)+(2.055), (I-749)+(1.062)+(2.056), (I-749)+(1.062)+(2.057), (I-749)+(1.062)+(2.058), (I-749)+(1.062)+(2.059), (I-749)+(1.062)+(3.001), (I-749)+(1.062)+(3.002), (I-749)+(1.062)+(3.003), (I-749)+(1.062)+(3.004), (I-749)+(1.062)+(3.005), (I-749)+(1.062)+(3.006), (I-749)+(1.062)+(3.007), (I-749)+(1.062)+(3.008), (I-749)+(1.062)+(3.009), (I-749)+(1.062)+(3.010), (I-749)+(1.062)+(3.011), (I-749)+(1.062)+(3.012), (I-749)+(1.062)+(3.013), (I-749)+(1.062)+(3.014), (I-749)+(1.062)+(3.015), (I-749)+(1.062)+(3.016), (I-749)+(1.062)+(3.017), (I-749)+(1.062)+(3.018), (I-749)+(1.062)+(3.019), (I-749)+(1.062)+(3.020), (I-749)+(1.062)+(3.021), (I-749)+(1.062)+(3.022), (I-749)+(1.062)+(3.023), (I-749)+(1.062)+(3.024), (I-749)+(1.062)+(3.025), (I-749)+(1.062)+(3.026), (I-749)+(1.062)+(3.027), (I-749)+(1.062)+(3.028), (I-749)+(1.062)+(3.029), (I-749)+(1.062)+(3.030), (I-749)+(1.062)+(3.031), (I-749)+(1.062)+(5.001), (I-749)+(1.062)+(5.002), (I-749)+(1.062)+(5.003), (I-749)+(1.062)+(5.004), (I-749)+(1.062)+(5.005), (I-749)+(1.062)+(5.006), (I-749)+(1.062)+(5.007), (I-749)+(1.062)+(5.008), (I-749)+(1.062)+(5.009), (I-749)+(1.062)+(5.010), (I-749)+(1.062)+(5.011), (I-749)+(1.062)+(5.012), (I-749)+(1.062)+(5.013), (I-749)+(1.062)+(5.014), (I-749)+(1.062)+(5.015), (I-749)+(1.062)+(5.016), (I-749)+(1.062)+(5.017), (I-749)+(1.062)+(5.018), (I-749)+(1.062)+(5.019), (I-749)+(1.062)+(5.020), (I-749)+(1.062)+(5.021), (I-749)+(1.062)+(5.022), (I-749)+(1.062)+(5.023), (I-749)+(1.062)+(6.001), (I-749)+(1.062)+(6.002), (I-749)+(1.062)+(6.003), (I-749)+(1.062)+(6.004), (I-749)+(1.062)+(7.001), (I-749)+(1.062)+(7.002), (I-749)+(1.062)+(7.003), (I-749)+(1.062)+(7.004), (I-749)+(1.062)+(7.005), (I-749)+(1.062)+(7.006), (I-749)+(1.062)+(9.001), (I-749)+(1.062)+(9.002), (I-749)+(1.062)+(9.003), (I-749)+(1.062)+(9.004), (I-749)+(1.062)+(9.005), (I-749)+(1.062)+(9.006), (I-749)+(1.062)+(9.007), (I-749)+(1.062)+(9.008), (I-749)+(1.062)+(9.009), (I-749)+(1.062)+(14.001), (I-749)+(1.062)+(14.002), (I-749)+(1.062)+(15.008), (I-749)+(1.062)+(15.011), (I-749)+(1.062)+(15.012), (I-749)+(1.062)+(15.016), (I-749)+(1.062)+(15.025), (I-749)+(1.062)+(15.027), (I-749)+(1.062)+(15.047), (I-749)+(1.062)+(15.063), (I-749)+(1.062)+(15.064), (I-749)+(1.062)+(16.001), (I-749)+(1.062)+(16.002), (I-749)+(1.062)+(16.003), (I-749)+(1.062)+(16.004), (I-749)+(1.062)+(16.005), (I-749)+(1.062)+(16.006), (I-749)+(1.062)+(16.007), (I-749)+(1.062)+(16.008), (I-749)+(1.062)+(17.001), (I-749)+(1.062)+(17.002), (I-749)+(1.062)+(17.003), (I-749)+(1.062)+(17.004), (I-749)+(1.062)+(17.005), (I-749)+(1.062)+(17.006), (I-749)+(1.062)+(17.007), (I-749)+(1.062)+(17.008), (I-749)+(1.062)+(17.009), (I-749)+(1.062)+(17.010), (I-749)+(1.062)+(17.011), (I-749)+(1.062)+(17.012), (I-749)+(1.062)+(18.001),

(I-749)+(1.063)+(1.064), (I-749)+(1.063)+(1.065), (I-749)+(1.063)+(1.066), (I-749)+(1.063)+(1.067), (I-749)+(1.063)+(1.068), (I-749)+(1.063)+(1.069), (I-749)+(1.063)+(1.070), (I-749)+(1.063)+(1.071), (I-749)+(1.063)+(1.072), (I-749)+(1.063)+(1.073), (I-749)+(1.063)+(1.074), (I-749)+(1.063)+(1.075), (I-749)+(1.063)+(1.076), (I-749)+(1.063)+(1.077), (I-749)+(1.063)+(1.078), (I-749)+(1.063)+(1.079), (I-749)+(1.063)+(1.080), (I-749)+(1.063)+(1.081), (I-749)+(1.063)+(1.082), (I-749)+(1.063)+(1.083), (I-749)+(1.063)+(1.084), (I-749)+(1.063)+(1.085), (I-749)+(1.063)+(1.086), (I-749)+(1.063)+(1.087), (I-749)+(1.063)+(1.088), (I-749)+(1.063)+(1.089), (I-749)+(1.063)+(1.090), (I-749)+(1.063)+(1.091), (I-749)+(1.063)+(1.092), (I-749)+(1.063)+(2.001), (I-749)+(1.063)+(2.002), (I-749)+(1.063)+(2.003), (I-749)+(1.063)+(2.004), (I-749)+(1.063)+(2.005), (I-749)+(1.063)+(2.006), (I-749)+(1.063)+(2.007), (I-749)+(1.063)+(2.008), (I-749)+(1.063)+(2.009), (I-749)+(1.063)+(2.010), (I-749)+(1.063)+(2.011), (I-749)+(1.063)+(2.012), (I-749)+(1.063)+(2.013), (I-749)+(1.063)+(2.014), (I-749)+(1.063)+(2.015), (I-749)+(1.063)+(2.016), (I-749)+(1.063)+(2.017), (I-749)+(1.063)+(2.018), (I-749)+(1.063)+(2.019), (I-749)+(1.063)+(2.020), (I-749)+(1.063)+(2.021), (I-749)+(1.063)+(2.022), (I-749)+(1.063)+(2.023), (I-749)+(1.063)+(2.024), (I-749)+(1.063)+(2.025), (I-749)+(1.063)+(2.026), (I-749)+(1.063)+(2.027), (I-749)+(1.063)+(2.028), (I-749)+(1.063)+(2.029), (I-749)+(1.063)+(2.030), (I-749)+(1.063)+(2.031), (I-749)+(1.063)+(2.032), (I-749)+(1.063)+(2.033), (I-749)+(1.063)+(2.034), (I-749)+(1.063)+(2.035), (I-749)+(1.063)+(2.036), (I-749)+(1.063)+(2.037), (I-749)+(1.063)+(2.038), (I-749)+(1.063)+(2.039), (I-749)+(1.063)+(2.040), (I-749)+(1.063)+(2.041), (I-749)+(1.063)+(2.042), (I-749)+(1.063)+(2.043), (I-749)+(1.063)+(2.044), (I-749)+(1.063)+(2.045), (I-749)+(1.063)+(2.046), (I-749)+(1.063)+(2.047), (I-749)+(1.063)+(2.048), (I-749)+(1.063)+(2.049), (I-749)+(1.063)+(2.050), (I-749)+(1.063)+(2.051), (I-749)+(1.063)+(2.052), (I-749)+(1.063)+(2.053), (I-749)+(1.063)+(2.054), (I-749)+(1.063)+(2.055), (I-749)+(1.063)+(2.056), (I-749)+(1.063)+(2.057), (I-749)+(1.063)+(2.058), (I-749)+(1.063)+(2.059), (I-749)+(1.063)+(3.001), (I-749)+(1.063)+(3.002), (I-749)+(1.063)+(3.003), (I-749)+(1.063)+(3.004), (I-749)+(1.063)+(3.005), (I-749)+(1.063)+(3.006), (I-749)+(1.063)+(3.007), (I-749)+(1.063)+(3.008), (I-749)+(1.063)+(3.009), (I-749)+(1.063)+(3.010), (I-749)+(1.063)+(3.011), (I-749)+(1.063)+(3.012), (I-749)+(1.063)+(3.013), (I-749)+(1.063)+(3.014), (I-749)+(1.063)+(3.015), (I-749)+(1.063)+(3.016), (I-749)+(1.063)+(3.017), (I-749)+(1.063)+(3.018), (I-749)+(1.063)+(3.019), (I-749)+(1.063)+(3.020), (I-749)+(1.063)+(3.021), (I-749)+(1.063)+(3.022), (I-749)+(1.063)+(3.023), (I-749)+(1.063)+(3.024), (I-749)+(1.063)+(3.025), (I-749)+(1.063)+(3.026), (I-749)+(1.063)+(3.027), (I-749)+(1.063)+(3.028), (I-749)+(1.063)+(3.029), (I-749)+(1.063)+(3.030), (I-749)+(1.063)+(3.031), (I-749)+(1.063)+(5.001), (I-749)+(1.063)+(5.002), (I-749)+(1.063)+(5.003), (I-749)+(1.063)+(5.004), (I-749)+(1.063)+(5.005), (I-749)+(1.063)+(5.006), (I-749)+(1.063)+(5.007), (I-749)+(1.063)+(5.008), (I-749)+(1.063)+(5.009), (I-749)+(1.063)+(5.010), (I-749)+(1.063)+(5.011), (I-749)+(1.063)+(5.012), (I-749)+(1.063)+(5.013), (I-749)+(1.063)+(5.014), (I-749)+(1.063)+(5.015), (I-749)+(1.063)+(5.016), (I-749)+(1.063)+(5.017), (I-749)+(1.063)+(5.018), (I-749)+(1.063)+(5.019), (I-749)+(1.063)+(5.020), (I-749)+(1.063)+(5.021), (I-749)+(1.063)+(5.022), (I-749)+(1.063)+(5.023), (I-749)+(1.063)+(6.001), (I-749)+(1.063)+(6.002), (I-749)+(1.063)+(6.003), (I-749)+(1.063)+(6.004), (I-749)+(1.063)+(7.001), (I-749)+(1.063)+(7.002), (I-749)+(1.063)+(7.003), (I-749)+(1.063)+(7.004), (I-749)+(1.063)+(7.005), (I-749)+(1.063)+(7.006), (I-749)+(1.063)+(9.001), (I-749)+(1.063)+(9.002), (I-749)+(1.063)+(9.003), (I-749)+(1.063)+(9.004), (I-749)+(1.063)+(9.005), (I-749)+(1.063)+(9.006), (I-749)+(1.063)+(9.007), (I-749)+(1.063)+(9.008), (I-749)+(1.063)+(9.009), (I-749)+(1.063)+(14.001), (I-749)+(1.063)+(14.002), (I-749)+(1.063)+(15.008), (I-749)+(1.063)+(15.011), (I-749)+(1.063)+(15.012), (I-749)+(1.063)+(15.016), (I-749)+(1.063)+(15.025), (I-749)+(1.063)+(15.027), (I-749)+(1.063)+(15.047), (I-749)+(1.063)+(15.063), (I-749)+(1.063)+(15.064), (I-749)+(1.063)+(16.001), (I-749)+(1.063)+(16.002), (I-749)+(1.063)+(16.003), (I-749)+(1.063)+(16.004), (I-749)+(1.063)+(16.005), (I-749)+(1.063)+(16.006), (I-749)+(1.063)+(16.007), (I-749)+(1.063)+(16.008), (I-749)+(1.063)+(17.001), (I-749)+(1.063)+(17.002), (I-749)+(1.063)+(17.003), (I-749)+(1.063)+(17.004), (I-749)+(1.063)+(17.005), (I-749)+(1.063)+(17.006), (I-749)+(1.063)+(17.007), (I-749)+(1.063)+(17.008), (I-749)+(1.063)+(17.009), (I-749)+(1.063)+(17.010), (I-749)+(1.063)+(17.011), (I-749)+(1.063)+(17.012), (I-749)+(1.063)+(18.001),

(I-749)+(1.064)+(1.065), (I-749)+(1.064)+(1.066), (I-749)+(1.064)+(1.067), (I-749)+(1.064)+(1.068), (I-749)+(1.064)+(1.069), (I-749)+(1.064)+(1.070), (I-749)+(1.064)+(1.071), (I-749)+(1.064)+(1.072), (I-749)+(1.064)+(1.073), (I-749)+(1.064)+(1.074), (I-749)+(1.064)+(1.075), (I-749)+(1.064)+(1.076), (I-749)+(1.064)+(1.077), (I-749)+(1.064)+(1.078), (I-749)+(1.064)+(1.079), (I-749)+(1.064)+(1.080), (I-749)+(1.064)+(1.081), (I-749)+(1.064)+(1.082), (I-749)+(1.064)+(1.083), (I-749)+(1.064)+(1.084), (I-749)+(1.064)+(1.085), (I-749)+(1.064)+(1.086), (I-749)+(1.064)+(1.087), (I-749)+(1.064)+(1.088), (I-749)+(1.064)+(1.089), (I-749)+(1.064)+(1.090), (I-749)+(1.064)+(1.091), (I-749)+(1.064)+(1.092), (I-749)+(1.064)+(2.001), (I-749)+(1.064)+(2.002), (I-749)+(1.064)+(2.003), (I-749)+(1.064)+(2.004), (I-749)+(1.064)+(2.005), (I-749)+(1.064)+(2.006), (I-749)+(1.064)+(2.007), (I-749)+(1.064)+(2.008), (I-749)+(1.064)+(2.009), (I-749)+(1.064)+(2.010), (I-749)+(1.064)+(2.011), (I-749)+(1.064)+(2.012), (I-749)+(1.064)+(2.013), (I-749)+(1.064)+(2.014), (I-749)+(1.064)+(2.015), (I-749)+(1.064)+(2.016), (I-749)+(1.064)+(2.017), (I-749)+(1.064)+(2.018), (I-749)+(1.064)+(2.019), (I-749)+(1.064)+(2.020), (I-749)+(1.064)+(2.021), (I-749)+(1.064)+(2.022), (I-749)+(1.064)+(2.023), (I-749)+(1.064)+(2.024), (I-749)+(1.064)+(2.025), (I-749)+(1.064)+(2.026), (I-749)+(1.064)+(2.027), (I-749)+(1.064)+(2.028), (I-749)+(1.064)+(2.029), (I-749)+(1.064)+(2.030), (I-749)+(1.064)+(2.031), (I-749)+(1.064)+(2.032), (I-749)+(1.064)+(2.033), (I-749)+(1.064)+(2.034), (I-749)+(1.064)+(2.035), (I-749)+(1.064)+(2.036), (I-749)+(1.064)+(2.037), (I-749)+(1.064)+(2.038), (I-749)+(1.064)+(2.039), (I-749)+(1.064)+(2.040), (I-749)+(1.064)+(2.041), (I-749)+(1.064)+(2.042), (I-749)+(1.064)+(2.043), (I-749)+(1.064)+(2.044), (I-749)+(1.064)+(2.045), (I-749)+(1.064)+(2.046), (I-749)+(1.064)+(2.047), (I-749)+(1.064)+(2.048), (I-749)+(1.064)+(2.049), (I-749)+(1.064)+(2.050), (I-749)+(1.064)+(2.051), (I-749)+(1.064)+(2.052), (I-749)+(1.064)+(2.053), (I-749)+(1.064)+(2.054), (I-749)+(1.064)+(2.055), (I-749)+(1.064)+(2.056), (I-749)+(1.064)+(2.057), (I-749)+(1.064)+(2.058), (I-749)+(1.064)+(2.059), (I-749)+(1.064)+(3.001), (I-749)+(1.064)+(3.002), (I-749)+(1.064)+(3.003), (I-749)+(1.064)+(3.004), (I-749)+(1.064)+(3.005), (I-749)+(1.064)+(3.006), (I-749)+(1.064)+(3.007), (I-749)+(1.064)+(3.008), (I-749)+(1.064)+(3.009), (I-749)+(1.064)+(3.010), (I-749)+(1.064)+(3.011), (I-749)+(1.064)+(3.012), (I-749)+(1.064)+(3.013), (I-749)+(1.064)+(3.014), (I-749)+(1.064)+(3.015), (I-749)+(1.064)+(3.016), (I-749)+(1.064)+(3.017), (I-749)+(1.064)+(3.018), (I-749)+(1.064)+(3.019), (I-749)+(1.064)+(3.020), (I-749)+(1.064)+(3.021), (I-749)+(1.064)+(3.022), (I-749)+(1.064)+(3.023), (I-749)+(1.064)+(3.024), (I-749)+(1.064)+(3.025), (I-749)+(1.064)+(3.026), (I-749)+(1.064)+(3.027), (I-749)+(1.064)+(3.028), (I-749)+(1.064)+(3.029), (I-749)+(1.064)+(3.030), (I-749)+(1.064)+(3.031), (I-749)+(1.064)+(5.001), (I-749)+(1.064)+(5.002), (I-749)+(1.064)+(5.003), (I-749)+(1.064)+(5.004), (I-749)+(1.064)+(5.005), (I-749)+(1.064)+(5.006), (I-749)+(1.064)+(5.007), (I-749)+(1.064)+(5.008), (I-749)+(1.064)+(5.009), (I-749)+(1.064)+(5.010), (I-749)+(1.064)+(5.011), (I-749)+(1.064)+(5.012), (I-749)+(1.064)+(5.013), (I-749)+(1.064)+(5.014), (I-749)+(1.064)+(5.015), (I-749)+(1.064)+(5.016), (I-749)+(1.064)+(5.017), (I-749)+(1.064)+(5.018), (I-749)+(1.064)+(5.019), (I-749)+(1.064)+(5.020), (I-749)+(1.064)+(5.021), (I-749)+(1.064)+(5.022), (I-749)+(1.064)+(5.023), (I-749)+(1.064)+(6.001), (I-749)+(1.064)+(6.002), (I-749)+(1.064)+(6.003), (I-749)+(1.064)+(6.004), (I-749)+(1.064)+(7.001), (I-749)+(1.064)+(7.002), (I-749)+(1.064)+(7.003), (I-749)+(1.064)+(7.004), (I-749)+(1.064)+(7.005), (I-749)+(1.064)+(7.006), (I-749)+(1.064)+(9.001), (I-749)+(1.064)+(9.002), (I-749)+(1.064)+(9.003), (I-749)+(1.064)+(9.004), (I-749)+(1.064)+(9.005), (I-749)+(1.064)+(9.006), (I-749)+(1.064)+(9.007), (I-749)+(1.064)+(9.008), (I-749)+(1.064)+(9.009), (I-749)+(1.064)+(14.001), (I-749)+(1.064)+(14.002), (I-749)+(1.064)+(15.008), (I-749)+(1.064)+(15.011), (I-749)+(1.064)+(15.012), (I-749)+(1.064)+(15.016), (I-749)+(1.064)+(15.025), (I-749)+(1.064)+(15.027), (I-749)+(1.064)+(15.047), (I-749)+(1.064)+(15.063), (I-749)+(1.064)+(15.064), (I-749)+(1.064)+(16.001), (I-749)+(1.064)+(16.002), (I-749)+(1.064)+(16.003), (I-749)+(1.064)+(16.004), (I-749)+(1.064)+(16.005), (I-749)+(1.064)+(16.006), (I-749)+(1.064)+(16.007), (I-749)+(1.064)+(16.008), (I-749)+(1.064)+(17.001), (I-749)+(1.064)+(17.002), (I-749)+(1.064)+(17.003), (I-749)+(1.064)+(17.004), (I-749)+(1.064)+(17.005), (I-749)+(1.064)+(17.006), (I-749)+(1.064)+(17.007), (I-749)+(1.064)+(17.008), (I-749)+(1.064)+(17.009), (I-749)+(1.064)+(17.010), (I-749)+(1.064)+(17.011), (I-749)+(1.064)+(17.012), (I-749)+(1.064)+(18.001),

(I-749)+(1.065)+(1.066), (I-749)+(1.065)+(1.067), (I-749)+(1.065)+(1.068), (I-749)+(1.065)+(1.069), (I-749)+(1.065)+(1.070), (I-749)+(1.065)+(1.071), (I-749)+(1.065)+(1.072), (I-749)+(1.065)+(1.073), (I-749)+(1.065)+(1.074), (I-749)+(1.065)+(1.075), (I-749)+(1.065)+(1.076), (I-749)+(1.065)+(1.077), (I-749)+(1.065)+(1.078), (I-749)+(1.065)+(1.079), (I-749)+(1.065)+(1.080), (I-749)+(1.065)+(1.081), (I-749)+(1.065)+(1.082), (I-749)+(1.065)+(1.083), (I-749)+(1.065)+(1.084), (I-749)+(1.065)+(1.085), (I-749)+(1.065)+(1.086), (I-749)+(1.065)+(1.087), (I-749)+(1.065)+(1.088), (I-749)+(1.065)+(1.089), (I-749)+(1.065)+(1.090), (I-749)+(1.065)+(1.091), (I-749)+(1.065)+(1.092), (I-749)+(1.065)+(2.001), (I-749)+(1.065)+(2.002), (I-749)+(1.065)+(2.003), (I-749)+(1.065)+(2.004), (I-749)+(1.065)+(2.005), (I-749)+(1.065)+(2.006), (I-749)+(1.065)+(2.007), (I-749)+(1.065)+(2.008), (I-749)+(1.065)+(2.009), (I-749)+(1.065)+(2.010), (I-749)+(1.065)+(2.011), (I-749)+(1.065)+(2.012), (I-749)+(1.065)+(2.013), (I-749)+(1.065)+(2.014), (I-749)+(1.065)+(2.015), (I-749)+(1.065)+(2.016), (I-749)+(1.065)+(2.017), (I-749)+(1.065)+(2.018), (I-749)+(1.065)+(2.019), (I-749)+(1.065)+(2.020), (I-749)+(1.065)+(2.021), (I-749)+(1.065)+(2.022), (I-749)+(1.065)+(2.023), (I-749)+(1.065)+(2.024), (I-749)+(1.065)+(2.025), (I-749)+(1.065)+(2.026), (I-749)+(1.065)+(2.027), (I-749)+(1.065)+(2.028), (I-749)+(1.065)+(2.029), (I-749)+(1.065)+(2.030), (I-749)+(1.065)+(2.031), (I-749)+(1.065)+(2.032), (I-749)+(1.065)+(2.033), (I-749)+(1.065)+(2.034), (I-749)+(1.065)+(2.035), (I-749)+(1.065)+(2.036), (I-749)+(1.065)+(2.037), (I-749)+(1.065)+(2.038), (I-749)+(1.065)+(2.039), (I-749)+(1.065)+(2.040), (I-749)+(1.065)+(2.041), (I-749)+(1.065)+(2.042), (I-749)+(1.065)+(2.043), (I-749)+(1.065)+(2.044), (I-749)+(1.065)+(2.045), (I-749)+(1.065)+(2.046), (I-749)+(1.065)+(2.047), (I-749)+(1.065)+(2.048), (I-749)+(1.065)+(2.049), (I-749)+(1.065)+(2.050), (I-749)+(1.065)+(2.051), (I-749)+(1.065)+(2.052), (I-749)+(1.065)+(2.053), (I-749)+(1.065)+(2.054), (I-749)+(1.065)+(2.055), (I-749)+(1.065)+(2.056), (I-749)+(1.065)+(2.057), (I-749)+(1.065)+(2.058), (I-749)+(1.065)+(2.059), (I-749)+(1.065)+(3.001), (I-749)+(1.065)+(3.002), (I-749)+(1.065)+(3.003), (I-749)+(1.065)+(3.004), (I-749)+(1.065)+(3.005), (I-749)+(1.065)+(3.006), (I-749)+(1.065)+(3.007), (I-749)+(1.065)+(3.008), (I-749)+(1.065)+(3.009), (I-749)+(1.065)+(3.010), (I-749)+(1.065)+(3.011), (I-749)+(1.065)+(3.012), (I-749)+(1.065)+(3.013), (I-749)+(1.065)+(3.014), (I-749)+(1.065)+(3.015), (I-749)+(1.065)+(3.016), (I-749)+(1.065)+(3.017), (I-749)+(1.065)+(3.018), (I-749)+(1.065)+(3.019), (I-749)+(1.065)+(3.020), (I-749)+(1.065)+(3.021), (I-749)+(1.065)+(3.022), (I-749)+(1.065)+(3.023), (I-749)+(1.065)+(3.024), (I-749)+(1.065)+(3.025), (I-749)+(1.065)+(3.026), (I-749)+(1.065)+(3.027), (I-749)+(1.065)+(3.028), (I-749)+(1.065)+(3.029), (I-749)+(1.065)+(3.030), (I-749)+(1.065)+(3.031), (I-749)+(1.065)+(5.001), (I-749)+(1.065)+(5.002), (I-749)+(1.065)+(5.003), (I-749)+(1.065)+(5.004), (I-749)+(1.065)+(5.005), (I-749)+(1.065)+(5.006), (I-749)+(1.065)+(5.007), (I-749)+(1.065)+(5.008), (I-749)+(1.065)+(5.009), (I-749)+(1.065)+(5.010), (I-749)+(1.065)+(5.011), (I-749)+(1.065)+(5.012), (I-749)+(1.065)+(5.013), (I-749)+(1.065)+(5.014), (I-749)+(1.065)+(5.015), (I-749)+(1.065)+(5.016), (I-749)+(1.065)+(5.017), (I-749)+(1.065)+(5.018), (I-749)+(1.065)+(5.019), (I-749)+(1.065)+(5.020), (I-749)+(1.065)+(5.021), (I-749)+(1.065)+(5.022), (I-749)+(1.065)+(5.023), (I-749)+(1.065)+(6.001), (I-749)+(1.065)+(6.002), (I-749)+(1.065)+(6.003), (I-749)+(1.065)+(6.004), (I-749)+(1.065)+(7.001), (I-749)+(1.065)+(7.002), (I-749)+(1.065)+(7.003), (I-749)+(1.065)+(7.004), (I-749)+(1.065)+(7.005), (I-749)+(1.065)+(7.006), (I-749)+(1.065)+(9.001), (I-749)+(1.065)+(9.002), (I-749)+(1.065)+(9.003), (I-749)+(1.065)+(9.004), (I-749)+(1.065)+(9.005), (I-749)+(1.065)+(9.006), (I-749)+(1.065)+(9.007), (I-749)+(1.065)+(9.008), (I-749)+(1.065)+(9.009), (I-749)+(1.065)+(14.001), (I-749)+(1.065)+(14.002), (I-749)+(1.065)+(15.008), (I-749)+(1.065)+(15.011), (I-749)+(1.065)+(15.012), (I-749)+(1.065)+(15.016), (I-749)+(1.065)+(15.025), (I-749)+(1.065)+(15.027), (I-749)+(1.065)+(15.047), (I-749)+(1.065)+(15.063), (I-749)+(1.065)+(15.064), (I-749)+(1.065)+(16.001), (I-749)+(1.065)+(16.002), (I-749)+(1.065)+(16.003), (I-749)+(1.065)+(16.004), (I-749)+(1.065)+(16.005), (I-749)+(1.065)+(16.006), (I-749)+(1.065)+(16.007), (I-749)+(1.065)+(16.008), (I-749)+(1.065)+(17.001), (I-749)+(1.065)+(17.002), (I-749)+(1.065)+(17.003), (I-749)+(1.065)+(17.004), (I-749)+(1.065)+(17.005), (I-749)+(1.065)+(17.006), (I-749)+(1.065)+(17.007), (I-749)+(1.065)+(17.008), (I-749)+(1.065)+(17.009), (I-749)+(1.065)+(17.010), (I-749)+(1.065)+(17.011), (I-749)+(1.065)+(17.012), (I-749)+(1.065)+(18.001),

(I-749)+(1.066)+(1.067), (I-749)+(1.066)+(1.068), (I-749)+(1.066)+(1.069), (I-749)+(1.066)+(1.070), (I-749)+(1.066)+(1.071), (I-749)+(1.066)+(1.072), (I-749)+(1.066)+(1.073), (I-749)+(1.066)+(1.074), (I-749)+(1.066)+(1.075), (I-749)+(1.066)+(1.076), (I-749)+(1.066)+(1.077), (I-749)+(1.066)+(1.078), (I-749)+(1.066)+(1.079), (I-749)+(1.066)+(1.080), (I-749)+(1.066)+(1.081), (I-749)+(1.066)+(1.082), (I-749)+(1.066)+(1.083), (I-749)+(1.066)+(1.084), (I-749)+(1.066)+(1.085), (I-749)+(1.066)+(1.086), (I-749)+(1.066)+(1.087), (I-749)+(1.066)+(1.088), (I-749)+(1.066)+(1.089), (I-749)+(1.066)+(1.090), (I-749)+(1.066)+(1.091), (I-749)+(1.066)+(1.092), (I-749)+(1.066)+(2.001), (I-749)+(1.066)+(2.002), (I-749)+(1.066)+(2.003), (I-749)+(1.066)+(2.004), (I-749)+(1.066)+(2.005), (I-749)+(1.066)+(2.006), (I-749)+(1.066)+(2.007), (I-749)+(1.066)+(2.008), (I-749)+(1.066)+(2.009), (I-749)+(1.066)+(2.010), (I-749)+(1.066)+(2.011), (I-749)+(1.066)+(2.012), (I-749)+(1.066)+(2.013), (I-749)+(1.066)+(2.014), (I-749)+(1.066)+(2.015), (I-749)+(1.066)+(2.016), (I-749)+(1.066)+(2.017), (I-749)+(1.066)+(2.018), (I-749)+(1.066)+(2.019), (I-749)+(1.066)+(2.020), (I-749)+(1.066)+(2.021), (I-749)+(1.066)+(2.022), (I-749)+(1.066)+(2.023), (I-749)+(1.066)+(2.024), (I-749)+(1.066)+(2.025), (I-749)+(1.066)+(2.026), (I-749)+(1.066)+(2.027), (I-749)+(1.066)+(2.028), (I-749)+(1.066)+(2.029), (I-749)+(1.066)+(2.030), (I-749)+(1.066)+(2.031), (I-749)+(1.066)+(2.032), (I-749)+(1.066)+(2.033), (I-749)+(1.066)+(2.034), (I-749)+(1.066)+(2.035), (I-749)+(1.066)+(2.036), (I-749)+(1.066)+(2.037), (I-749)+(1.066)+(2.038), (I-749)+(1.066)+(2.039), (I-749)+(1.066)+(2.040), (I-749)+(1.066)+(2.041), (I-749)+(1.066)+(2.042), (I-749)+(1.066)+(2.043), (I-749)+(1.066)+(2.044), (I-749)+(1.066)+(2.045), (I-749)+(1.066)+(2.046), (I-749)+(1.066)+(2.047), (I-749)+(1.066)+(2.048), (I-749)+(1.066)+(2.049), (I-749)+(1.066)+(2.050), (I-749)+(1.066)+(2.051), (I-749)+(1.066)+(2.052), (I-749)+(1.066)+(2.053), (I-749)+(1.066)+(2.054), (I-749)+(1.066)+(2.055), (I-749)+(1.066)+(2.056), (I-749)+(1.066)+(2.057), (I-749)+(1.066)+(2.058), (I-749)+(1.066)+(2.059), (I-749)+(1.066)+(3.001), (I-749)+(1.066)+(3.002), (I-749)+(1.066)+(3.003), (I-749)+(1.066)+(3.004), (I-749)+(1.066)+(3.005), (I-749)+(1.066)+(3.006), (I-749)+(1.066)+(3.007), (I-749)+(1.066)+(3.008), (I-749)+(1.066)+(3.009), (I-749)+(1.066)+(3.010), (I-749)+(1.066)+(3.011), (I-749)+(1.066)+(3.012), (I-749)+(1.066)+(3.013), (I-749)+(1.066)+(3.014), (I-749)+(1.066)+(3.015), (I-749)+(1.066)+(3.016), (I-749)+(1.066)+(3.017), (I-749)+(1.066)+(3.018), (I-749)+(1.066)+(3.019), (I-749)+(1.066)+(3.020), (I-749)+(1.066)+(3.021), (I-749)+(1.066)+(3.022), (I-749)+(1.066)+(3.023), (I-749)+(1.066)+(3.024), (I-749)+(1.066)+(3.025), (I-749)+(1.066)+(3.026), (I-749)+(1.066)+(3.027), (I-749)+(1.066)+(3.028), (I-749)+(1.066)+(3.029), (I-749)+(1.066)+(3.030), (I-749)+(1.066)+(3.031), (I-749)+(1.066)+(5.001), (I-749)+(1.066)+(5.002), (I-749)+(1.066)+(5.003), (I-749)+(1.066)+(5.004), (I-749)+(1.066)+(5.005), (I-749)+(1.066)+(5.006), (I-749)+(1.066)+(5.007), (I-749)+(1.066)+(5.008), (I-749)+(1.066)+(5.009), (I-749)+(1.066)+(5.010), (I-749)+(1.066)+(5.011), (I-749)+(1.066)+(5.012), (I-749)+(1.066)+(5.013), (I-749)+(1.066)+(5.014), (I-749)+(1.066)+(5.015), (I-749)+(1.066)+(5.016), (I-749)+(1.066)+(5.017), (I-749)+(1.066)+(5.018), (I-749)+(1.066)+(5.019), (I-749)+(1.066)+(5.020), (I-749)+(1.066)+(5.021), (I-749)+(1.066)+(5.022), (I-749)+(1.066)+(5.023), (I-749)+(1.066)+(6.001), (I-749)+(1.066)+(6.002), (I-749)+(1.066)+(6.003), (I-749)+(1.066)+(6.004), (I-749)+(1.066)+(7.001), (I-749)+(1.066)+(7.002), (I-749)+(1.066)+(7.003), (I-749)+(1.066)+(7.004), (I-749)+(1.066)+(7.005), (I-749)+(1.066)+(7.006), (I-749)+(1.066)+(9.001), (I-749)+(1.066)+(9.002), (I-749)+(1.066)+(9.003), (I-749)+(1.066)+(9.004), (I-749)+(1.066)+(9.005), (I-749)+(1.066)+(9.006), (I-749)+(1.066)+(9.007), (I-749)+(1.066)+(9.008), (I-749)+(1.066)+(9.009), (I-749)+(1.066)+(14.001), (I-749)+(1.066)+(14.002), (I-749)+(1.066)+(15.008), (I-749)+(1.066)+(15.011), (I-749)+(1.066)+(15.012), (I-749)+(1.066)+(15.016), (I-749)+(1.066)+(15.025), (I-749)+(1.066)+(15.027), (I-749)+(1.066)+(15.047), (I-749)+(1.066)+(15.063), (I-749)+(1.066)+(15.064), (I-749)+(1.066)+(16.001), (I-749)+(1.066)+(16.002), (I-749)+(1.066)+(16.003), (I-749)+(1.066)+(16.004), (I-749)+(1.066)+(16.005), (I-749)+(1.066)+(16.006), (I-749)+(1.066)+(16.007), (I-749)+(1.066)+(16.008), (I-749)+(1.066)+(17.001), (I-749)+(1.066)+(17.002), (I-749)+(1.066)+(17.003), (I-749)+(1.066)+(17.004), (I-749)+(1.066)+(17.005), (I-749)+(1.066)+(17.006), (I-749)+(1.066)+(17.007), (I-749)+(1.066)+(17.008), (I-749)+(1.066)+(17.009), (I-749)+(1.066)+(17.010), (I-749)+(1.066)+(17.011), (I-749)+(1.066)+(17.012), (I-749)+(1.066)+(18.001),

(I-749)+(1.067)+(1.068), (I-749)+(1.067)+(1.069), (I-749)+(1.067)+(1.070), (I-749)+(1.067)+(1.071), (I-749)+(1.067)+(1.072), (I-749)+(1.067)+(1.073), (I-749)+(1.067)+(1.074), (I-749)+(1.067)+(1.075), (I-749)+(1.067)+(1.076), (I-749)+(1.067)+(1.077), (I-749)+(1.067)+(1.078), (I-749)+(1.067)+(1.079), (I-749)+(1.067)+(1.080), (I-749)+(1.067)+(1.081), (I-749)+(1.067)+(1.082), (I-749)+(1.067)+(1.083), (I-749)+(1.067)+(1.084), (I-749)+(1.067)+(1.085), (I-749)+(1.067)+(1.086), (I-749)+(1.067)+(1.087), (I-749)+(1.067)+(1.088), (I-749)+(1.067)+(1.089), (I-749)+(1.067)+(1.090), (I-749)+(1.067)+(1.091), (I-749)+(1.067)+(1.092), (I-749)+(1.067)+(2.001), (I-749)+(1.067)+(2.002), (I-749)+(1.067)+(2.003), (I-749)+(1.067)+(2.004), (I-749)+(1.067)+(2.005), (I-749)+(1.067)+(2.006), (I-749)+(1.067)+(2.007), (I-749)+(1.067)+(2.008), (I-749)+(1.067)+(2.009), (I-749)+(1.067)+(2.010), (I-749)+(1.067)+(2.011), (I-749)+(1.067)+(2.012), (I-749)+(1.067)+(2.013), (I-749)+(1.067)+(2.014), (I-749)+(1.067)+(2.015), (I-749)+(1.067)+(2.016), (I-749)+(1.067)+(2.017), (I-749)+(1.067)+(2.018), (I-749)+(1.067)+(2.019), (I-749)+(1.067)+(2.020), (I-749)+(1.067)+(2.021), (I-749)+(1.067)+(2.022), (I-749)+(1.067)+(2.023), (I-749)+(1.067)+(2.024), (I-749)+(1.067)+(2.025), (I-749)+(1.067)+(2.026), (I-749)+(1.067)+(2.027), (I-749)+(1.067)+(2.028), (I-749)+(1.067)+(2.029), (I-749)+(1.067)+(2.030), (I-749)+(1.067)+(2.031), (I-749)+(1.067)+(2.032), (I-749)+(1.067)+(2.033), (I-749)+(1.067)+(2.034), (I-749)+(1.067)+(2.035), (I-749)+(1.067)+(2.036), (I-749)+(1.067)+(2.037), (I-749)+(1.067)+(2.038), (I-749)+(1.067)+(2.039), (I-749)+(1.067)+(2.040), (I-749)+(1.067)+(2.041), (I-749)+(1.067)+(2.042), (I-749)+(1.067)+(2.043), (I-749)+(1.067)+(2.044), (I-749)+(1.067)+(2.045), (I-749)+(1.067)+(2.046), (I-749)+(1.067)+(2.047), (I-749)+(1.067)+(2.048), (I-749)+(1.067)+(2.049), (I-749)+(1.067)+(2.050), (I-749)+(1.067)+(2.051), (I-749)+(1.067)+(2.052), (I-749)+(1.067)+(2.053), (I-749)+(1.067)+(2.054), (I-749)+(1.067)+(2.055), (I-749)+(1.067)+(2.056), (I-749)+(1.067)+(2.057), (I-749)+(1.067)+(2.058), (I-749)+(1.067)+(2.059), (I-749)+(1.067)+(3.001), (I-749)+(1.067)+(3.002), (I-749)+(1.067)+(3.003), (I-749)+(1.067)+(3.004), (I-749)+(1.067)+(3.005), (I-749)+(1.067)+(3.006), (I-749)+(1.067)+(3.007), (I-749)+(1.067)+(3.008), (I-749)+(1.067)+(3.009), (I-749)+(1.067)+(3.010), (I-749)+(1.067)+(3.011), (I-749)+(1.067)+(3.012), (I-749)+(1.067)+(3.013), (I-749)+(1.067)+(3.014), (I-749)+(1.067)+(3.015), (I-749)+(1.067)+(3.016), (I-749)+(1.067)+(3.017), (I-749)+(1.067)+(3.018), (I-749)+(1.067)+(3.019), (I-749)+(1.067)+(3.020), (I-749)+(1.067)+(3.021), (I-749)+(1.067)+(3.022), (I-749)+(1.067)+(3.023), (I-749)+(1.067)+(3.024), (I-749)+(1.067)+(3.025), (I-749)+(1.067)+(3.026), (I-749)+(1.067)+(3.027), (I-749)+(1.067)+(3.028), (I-749)+(1.067)+(3.029), (I-749)+(1.067)+(3.030), (I-749)+(1.067)+(3.031), (I-749)+(1.067)+(5.001), (I-749)+(1.067)+(5.002), (I-749)+(1.067)+(5.003), (I-749)+(1.067)+(5.004), (I-749)+(1.067)+(5.005), (I-749)+(1.067)+(5.006), (I-749)+(1.067)+(5.007), (I-749)+(1.067)+(5.008), (I-749)+(1.067)+(5.009), (I-749)+(1.067)+(5.010), (I-749)+(1.067)+(5.011), (I-749)+(1.067)+(5.012), (I-749)+(1.067)+(5.013), (I-749)+(1.067)+(5.014), (I-749)+(1.067)+(5.015), (I-749)+(1.067)+(5.016), (I-749)+(1.067)+(5.017), (I-749)+(1.067)+(5.018), (I-749)+(1.067)+(5.019), (I-749)+(1.067)+(5.020), (I-749)+(1.067)+(5.021), (I-749)+(1.067)+(5.022), (I-749)+(1.067)+(5.023), (I-749)+(1.067)+(6.001), (I-749)+(1.067)+(6.002), (I-749)+(1.067)+(6.003), (I-749)+(1.067)+(6.004), (I-749)+(1.067)+(7.001), (I-749)+(1.067)+(7.002), (I-749)+(1.067)+(7.003), (I-749)+(1.067)+(7.004), (I-749)+(1.067)+(7.005), (I-749)+(1.067)+(7.006), (I-749)+(1.067)+(9.001), (I-749)+(1.067)+(9.002), (I-749)+(1.067)+(9.003), (I-749)+(1.067)+(9.004), (I-749)+(1.067)+(9.005), (I-749)+(1.067)+(9.006), (I-749)+(1.067)+(9.007), (I-749)+(1.067)+(9.008), (I-749)+(1.067)+(9.009), (I-749)+(1.067)+(14.001), (I-749)+(1.067)+(14.002), (I-749)+(1.067)+(15.008), (I-749)+(1.067)+(15.011), (I-749)+(1.067)+(15.012), (I-749)+(1.067)+(15.016), (I-749)+(1.067)+(15.025), (I-749)+(1.067)+(15.027), (I-749)+(1.067)+(15.047), (I-749)+(1.067)+(15.063), (I-749)+(1.067)+(15.064), (I-749)+(1.067)+(16.001), (I-749)+(1.067)+(16.002), (I-749)+(1.067)+(16.003), (I-749)+(1.067)+(16.004), (I-749)+(1.067)+(16.005), (I-749)+(1.067)+(16.006), (I-749)+(1.067)+(16.007), (I-749)+(1.067)+(16.008), (I-749)+(1.067)+(17.001), (I-749)+(1.067)+(17.002), (I-749)+(1.067)+(17.003), (I-749)+(1.067)+(17.004), (I-749)+(1.067)+(17.005), (I-749)+(1.067)+(17.006), (I-749)+(1.067)+(17.007), (I-749)+(1.067)+(17.008), (I-749)+(1.067)+(17.009), (I-749)+(1.067)+(17.010), (I-749)+(1.067)+(17.011), (I-749)+(1.067)+(17.012), (I-749)+(1.067)+(18.001),

(I-749)+(1.068)+(1.069), (I-749)+(1.068)+(1.070), (I-749)+(1.068)+(1.071), (I-749)+(1.068)+(1.072), (I-749)+(1.068)+(1.073), (I-749)+(1.068)+(1.074), (I-749)+(1.068)+(1.075), (I-749)+(1.068)+(1.076), (I-749)+(1.068)+(1.077), (I-749)+(1.068)+(1.078), (I-749)+(1.068)+(1.079), (I-749)+(1.068)+(1.080), (I-749)+(1.068)+(1.081), (I-749)+(1.068)+(1.082), (I-749)+(1.068)+(1.083), (I-749)+(1.068)+(1.084), (I-749)+(1.068)+(1.085), (I-749)+(1.068)+(1.086), (I-749)+(1.068)+(1.087), (I-749)+(1.068)+(1.088), (I-749)+(1.068)+(1.089), (I-749)+(1.068)+(1.090), (I-749)+(1.068)+(1.091), (I-749)+(1.068)+(1.092), (I-749)+(1.068)+(2.001), (I-749)+(1.068)+(2.002), (I-749)+(1.068)+(2.003), (I-749)+(1.068)+(2.004), (I-749)+(1.068)+(2.005), (I-749)+(1.068)+(2.006), (I-749)+(1.068)+(2.007), (I-749)+(1.068)+(2.008), (I-749)+(1.068)+(2.009), (I-749)+(1.068)+(2.010), (I-749)+(1.068)+(2.011), (I-749)+(1.068)+(2.012), (I-749)+(1.068)+(2.013), (I-749)+(1.068)+(2.014), (I-749)+(1.068)+(2.015), (I-749)+(1.068)+(2.016), (I-749)+(1.068)+(2.017), (I-749)+(1.068)+(2.018), (I-749)+(1.068)+(2.019), (I-749)+(1.068)+(2.020), (I-749)+(1.068)+(2.021), (I-749)+(1.068)+(2.022), (I-749)+(1.068)+(2.023), (I-749)+(1.068)+(2.024), (I-749)+(1.068)+(2.025), (I-749)+(1.068)+(2.026), (I-749)+(1.068)+(2.027), (I-749)+(1.068)+(2.028), (I-749)+(1.068)+(2.029), (I-749)+(1.068)+(2.030), (I-749)+(1.068)+(2.031), (I-749)+(1.068)+(2.032), (I-749)+(1.068)+(2.033), (I-749)+(1.068)+(2.034), (I-749)+(1.068)+(2.035), (I-749)+(1.068)+(2.036), (I-749)+(1.068)+(2.037), (I-749)+(1.068)+(2.038), (I-749)+(1.068)+(2.039), (I-749)+(1.068)+(2.040), (I-749)+(1.068)+(2.041), (I-749)+(1.068)+(2.042), (I-749)+(1.068)+(2.043), (I-749)+(1.068)+(2.044), (I-749)+(1.068)+(2.045), (I-749)+(1.068)+(2.046), (I-749)+(1.068)+(2.047), (I-749)+(1.068)+(2.048), (I-749)+(1.068)+(2.049), (I-749)+(1.068)+(2.050), (I-749)+(1.068)+(2.051), (I-749)+(1.068)+(2.052), (I-749)+(1.068)+(2.053), (I-749)+(1.068)+(2.054), (I-749)+(1.068)+(2.055), (I-749)+(1.068)+(2.056), (I-749)+(1.068)+(2.057), (I-749)+(1.068)+(2.058), (I-749)+(1.068)+(2.059), (I-749)+(1.068)+(3.001), (I-749)+(1.068)+(3.002), (I-749)+(1.068)+(3.003), (I-749)+(1.068)+(3.004), (I-749)+(1.068)+(3.005), (I-749)+(1.068)+(3.006), (I-749)+(1.068)+(3.007), (I-749)+(1.068)+(3.008), (I-749)+(1.068)+(3.009), (I-749)+(1.068)+(3.010), (I-749)+(1.068)+(3.011), (I-749)+(1.068)+(3.012), (I-749)+(1.068)+(3.013), (I-749)+(1.068)+(3.014), (I-749)+(1.068)+(3.015), (I-749)+(1.068)+(3.016), (I-749)+(1.068)+(3.017), (I-749)+(1.068)+(3.018), (I-749)+(1.068)+(3.019), (I-749)+(1.068)+(3.020), (I-749)+(1.068)+(3.021), (I-749)+(1.068)+(3.022), (I-749)+(1.068)+(3.023), (I-749)+(1.068)+(3.024), (I-749)+(1.068)+(3.025), (I-749)+(1.068)+(3.026), (I-749)+(1.068)+(3.027), (I-749)+(1.068)+(3.028), (I-749)+(1.068)+(3.029), (I-749)+(1.068)+(3.030), (I-749)+(1.068)+(3.031), (I-749)+(1.068)+(5.001), (I-749)+(1.068)+(5.002), (I-749)+(1.068)+(5.003), (I-749)+(1.068)+(5.004), (I-749)+(1.068)+(5.005), (I-749)+(1.068)+(5.006), (I-749)+(1.068)+(5.007), (I-749)+(1.068)+(5.008), (I-749)+(1.068)+(5.009), (I-749)+(1.068)+(5.010), (I-749)+(1.068)+(5.011), (I-749)+(1.068)+(5.012), (I-749)+(1.068)+(5.013), (I-749)+(1.068)+(5.014), (I-749)+(1.068)+(5.015), (I-749)+(1.068)+(5.016), (I-749)+(1.068)+(5.017), (I-749)+(1.068)+(5.018), (I-749)+(1.068)+(5.019), (I-749)+(1.068)+(5.020), (I-749)+(1.068)+(5.021), (I-749)+(1.068)+(5.022), (I-749)+(1.068)+(5.023), (I-749)+(1.068)+(6.001), (I-749)+(1.068)+(6.002), (I-749)+(1.068)+(6.003), (I-749)+(1.068)+(6.004), (I-749)+(1.068)+(7.001), (I-749)+(1.068)+(7.002), (I-749)+(1.068)+(7.003), (I-749)+(1.068)+(7.004), (I-749)+(1.068)+(7.005), (I-749)+(1.068)+(7.006), (I-749)+(1.068)+(9.001), (I-749)+(1.068)+(9.002), (I-749)+(1.068)+(9.003), (I-749)+(1.068)+(9.004), (I-749)+(1.068)+(9.005), (I-749)+(1.068)+(9.006), (I-749)+(1.068)+(9.007), (I-749)+(1.068)+(9.008), (I-749)+(1.068)+(9.009), (I-749)+(1.068)+(14.001), (I-749)+(1.068)+(14.002), (I-749)+(1.068)+(15.008), (I-749)+(1.068)+(15.011), (I-749)+(1.068)+(15.012), (I-749)+(1.068)+(15.016), (I-749)+(1.068)+(15.025), (I-749)+(1.068)+(15.027), (I-749)+(1.068)+(15.047), (I-749)+(1.068)+(15.063), (I-749)+(1.068)+(15.064), (I-749)+(1.068)+(16.001), (I-749)+(1.068)+(16.002), (I-749)+(1.068)+(16.003), (I-749)+(1.068)+(16.004), (I-749)+(1.068)+(16.005), (I-749)+(1.068)+(16.006), (I-749)+(1.068)+(16.007), (I-749)+(1.068)+(16.008), (I-749)+(1.068)+(17.001), (I-749)+(1.068)+(17.002), (I-749)+(1.068)+(17.003), (I-749)+(1.068)+(17.004), (I-749)+(1.068)+(17.005), (I-749)+(1.068)+(17.006), (I-749)+(1.068)+(17.007), (I-749)+(1.068)+(17.008), (I-749)+(1.068)+(17.009), (I-749)+(1.068)+(17.010), (I-749)+(1.068)+(17.011), (I-749)+(1.068)+(17.012), (I-749)+(1.068)+(18.001),

(I-749)+(1.069)+(1.070), (I-749)+(1.069)+(1.071), (I-749)+(1.069)+(1.072), (I-749)+(1.069)+(1.073), (I-749)+(1.069)+(1.074), (I-749)+(1.069)+(1.075), (I-749)+(1.069)+(1.076), (I-749)+(1.069)+(1.077), (I-749)+(1.069)+(1.078), (I-749)+(1.069)+(1.079), (I-749)+(1.069)+(1.080), (I-749)+(1.069)+(1.081), (I-749)+(1.069)+(1.082), (I-749)+(1.069)+(1.083), (I-749)+(1.069)+(1.084), (I-749)+(1.069)+(1.085), (I-749)+(1.069)+(1.086), (I-749)+(1.069)+(1.087), (I-749)+(1.069)+(1.088), (I-749)+(1.069)+(1.089), (I-749)+(1.069)+(1.090), (I-749)+(1.069)+(1.091), (I-749)+(1.069)+(1.092), (I-749)+(1.069)+(2.001), (I-749)+(1.069)+(2.002), (I-749)+(1.069)+(2.003), (I-749)+(1.069)+(2.004), (I-749)+(1.069)+(2.005), (I-749)+(1.069)+(2.006), (I-749)+(1.069)+(2.007), (I-749)+(1.069)+(2.008), (I-749)+(1.069)+(2.009), (I-749)+(1.069)+(2.010), (I-749)+(1.069)+(2.011), (I-749)+(1.069)+(2.012), (I-749)+(1.069)+(2.013), (I-749)+(1.069)+(2.014), (I-749)+(1.069)+(2.015), (I-749)+(1.069)+(2.016), (I-749)+(1.069)+(2.017), (I-749)+(1.069)+(2.018), (I-749)+(1.069)+(2.019), (I-749)+(1.069)+(2.020), (I-749)+(1.069)+(2.021), (I-749)+(1.069)+(2.022), (I-749)+(1.069)+(2.023), (I-749)+(1.069)+(2.024), (I-749)+(1.069)+(2.025), (I-749)+(1.069)+(2.026), (I-749)+(1.069)+(2.027), (I-749)+(1.069)+(2.028), (I-749)+(1.069)+(2.029), (I-749)+(1.069)+(2.030), (I-749)+(1.069)+(2.031), (I-749)+(1.069)+(2.032), (I-749)+(1.069)+(2.033), (I-749)+(1.069)+(2.034), (I-749)+(1.069)+(2.035), (I-749)+(1.069)+(2.036), (I-749)+(1.069)+(2.037), (I-749)+(1.069)+(2.038), (I-749)+(1.069)+(2.039), (I-749)+(1.069)+(2.040), (I-749)+(1.069)+(2.041), (I-749)+(1.069)+(2.042), (I-749)+(1.069)+(2.043), (I-749)+(1.069)+(2.044), (I-749)+(1.069)+(2.045), (I-749)+(1.069)+(2.046), (I-749)+(1.069)+(2.047), (I-749)+(1.069)+(2.048), (I-749)+(1.069)+(2.049), (I-749)+(1.069)+(2.050), (I-749)+(1.069)+(2.051), (I-749)+(1.069)+(2.052), (I-749)+(1.069)+(2.053), (I-749)+(1.069)+(2.054), (I-749)+(1.069)+(2.055), (I-749)+(1.069)+(2.056), (I-749)+(1.069)+(2.057), (I-749)+(1.069)+(2.058), (I-749)+(1.069)+(2.059), (I-749)+(1.069)+(3.001), (I-749)+(1.069)+(3.002), (I-749)+(1.069)+(3.003), (I-749)+(1.069)+(3.004), (I-749)+(1.069)+(3.005), (I-749)+(1.069)+(3.006), (I-749)+(1.069)+(3.007), (I-749)+(1.069)+(3.008), (I-749)+(1.069)+(3.009), (I-749)+(1.069)+(3.010), (I-749)+(1.069)+(3.011), (I-749)+(1.069)+(3.012), (I-749)+(1.069)+(3.013), (I-749)+(1.069)+(3.014), (I-749)+(1.069)+(3.015), (I-749)+(1.069)+(3.016), (I-749)+(1.069)+(3.017), (I-749)+(1.069)+(3.018), (I-749)+(1.069)+(3.019), (I-749)+(1.069)+(3.020), (I-749)+(1.069)+(3.021), (I-749)+(1.069)+(3.022), (I-749)+(1.069)+(3.023), (I-749)+(1.069)+(3.024), (I-749)+(1.069)+(3.025), (I-749)+(1.069)+(3.026), (I-749)+(1.069)+(3.027), (I-749)+(1.069)+(3.028), (I-749)+(1.069)+(3.029), (I-749)+(1.069)+(3.030), (I-749)+(1.069)+(3.031), (I-749)+(1.069)+(5.001), (I-749)+(1.069)+(5.002), (I-749)+(1.069)+(5.003), (I-749)+(1.069)+(5.004), (I-749)+(1.069)+(5.005), (I-749)+(1.069)+(5.006), (I-749)+(1.069)+(5.007), (I-749)+(1.069)+(5.008), (I-749)+(1.069)+(5.009), (I-749)+(1.069)+(5.010), (I-749)+(1.069)+(5.011), (I-749)+(1.069)+(5.012), (I-749)+(1.069)+(5.013), (I-749)+(1.069)+(5.014), (I-749)+(1.069)+(5.015), (I-749)+(1.069)+(5.016), (I-749)+(1.069)+(5.017), (I-749)+(1.069)+(5.018), (I-749)+(1.069)+(5.019), (I-749)+(1.069)+(5.020), (I-749)+(1.069)+(5.021), (I-749)+(1.069)+(5.022), (I-749)+(1.069)+(5.023), (I-749)+(1.069)+(6.001), (I-749)+(1.069)+(6.002), (I-749)+(1.069)+(6.003), (I-749)+(1.069)+(6.004), (I-749)+(1.069)+(7.001), (I-749)+(1.069)+(7.002), (I-749)+(1.069)+(7.003), (I-749)+(1.069)+(7.004), (I-749)+(1.069)+(7.005), (I-749)+(1.069)+(7.006), (I-749)+(1.069)+(9.001), (I-749)+(1.069)+(9.002), (I-749)+(1.069)+(9.003), (I-749)+(1.069)+(9.004), (I-749)+(1.069)+(9.005), (I-749)+(1.069)+(9.006), (I-749)+(1.069)+(9.007), (I-749)+(1.069)+(9.008), (I-749)+(1.069)+(9.009), (I-749)+(1.069)+(14.001), (I-749)+(1.069)+(14.002), (I-749)+(1.069)+(15.008), (I-749)+(1.069)+(15.011), (I-749)+(1.069)+(15.012), (I-749)+(1.069)+(15.016), (I-749)+(1.069)+(15.025), (I-749)+(1.069)+(15.027), (I-749)+(1.069)+(15.047), (I-749)+(1.069)+(15.063), (I-749)+(1.069)+(15.064), (I-749)+(1.069)+(16.001), (I-749)+(1.069)+(16.002), (I-749)+(1.069)+(16.003), (I-749)+(1.069)+(16.004), (I-749)+(1.069)+(16.005), (I-749)+(1.069)+(16.006), (I-749)+(1.069)+(16.007), (I-749)+(1.069)+(16.008), (I-749)+(1.069)+(17.001), (I-749)+(1.069)+(17.002), (I-749)+(1.069)+(17.003), (I-749)+(1.069)+(17.004), (I-749)+(1.069)+(17.005), (I-749)+(1.069)+(17.006), (I-749)+(1.069)+(17.007), (I-749)+(1.069)+(17.008), (I-749)+(1.069)+(17.009), (I-749)+(1.069)+(17.010), (I-749)+(1.069)+(17.011), (I-749)+(1.069)+(17.012), (I-749)+(1.069)+(18.001),

(I-749)+(1.070)+(1.071), (I-749)+(1.070)+(1.072), (I-749)+(1.070)+(1.073), (I-749)+(1.070)+(1.074), (I-749)+(1.070)+(1.075), (I-749)+(1.070)+(1.076), (I-749)+(1.070)+(1.077), (I-749)+(1.070)+(1.078), (I-749)+(1.070)+(1.079), (I-749)+(1.070)+(1.080), (I-749)+(1.070)+(1.081), (I-749)+(1.070)+(1.082), (I-749)+(1.070)+(1.083), (I-749)+(1.070)+(1.084), (I-749)+(1.070)+(1.085), (I-749)+(1.070)+(1.086), (I-749)+(1.070)+(1.087), (I-749)+(1.070)+(1.088), (I-749)+(1.070)+(1.089), (I-749)+(1.070)+(1.090), (I-749)+(1.070)+(1.091), (I-749)+(1.070)+(1.092), (I-749)+(1.070)+(2.001), (I-749)+(1.070)+(2.002), (I-749)+(1.070)+(2.003), (I-749)+(1.070)+(2.004), (I-749)+(1.070)+(2.005), (I-749)+(1.070)+(2.006), (I-749)+(1.070)+(2.007), (I-749)+(1.070)+(2.008), (I-749)+(1.070)+(2.009), (I-749)+(1.070)+(2.010), (I-749)+(1.070)+(2.011), (I-749)+(1.070)+(2.012), (I-749)+(1.070)+(2.013), (I-749)+(1.070)+(2.014), (I-749)+(1.070)+(2.015), (I-749)+(1.070)+(2.016), (I-749)+(1.070)+(2.017), (I-749)+(1.070)+(2.018), (I-749)+(1.070)+(2.019), (I-749)+(1.070)+(2.020), (I-749)+(1.070)+(2.021), (I-749)+(1.070)+(2.022), (I-749)+(1.070)+(2.023), (I-749)+(1.070)+(2.024), (I-749)+(1.070)+(2.025), (I-749)+(1.070)+(2.026), (I-749)+(1.070)+(2.027), (I-749)+(1.070)+(2.028), (I-749)+(1.070)+(2.029), (I-749)+(1.070)+(2.030), (I-749)+(1.070)+(2.031), (I-749)+(1.070)+(2.032), (I-749)+(1.070)+(2.033), (I-749)+(1.070)+(2.034), (I-749)+(1.070)+(2.035), (I-749)+(1.070)+(2.036), (I-749)+(1.070)+(2.037), (I-749)+(1.070)+(2.038), (I-749)+(1.070)+(2.039), (I-749)+(1.070)+(2.040), (I-749)+(1.070)+(2.041), (I-749)+(1.070)+(2.042), (I-749)+(1.070)+(2.043), (I-749)+(1.070)+(2.044), (I-749)+(1.070)+(2.045), (I-749)+(1.070)+(2.046), (I-749)+(1.070)+(2.047), (I-749)+(1.070)+(2.048), (I-749)+(1.070)+(2.049), (I-749)+(1.070)+(2.050), (I-749)+(1.070)+(2.051), (I-749)+(1.070)+(2.052), (I-749)+(1.070)+(2.053), (I-749)+(1.070)+(2.054), (I-749)+(1.070)+(2.055), (I-749)+(1.070)+(2.056), (I-749)+(1.070)+(2.057), (I-749)+(1.070)+(2.058), (I-749)+(1.070)+(2.059), (I-749)+(1.070)+(3.001), (I-749)+(1.070)+(3.002), (I-749)+(1.070)+(3.003), (I-749)+(1.070)+(3.004), (I-749)+(1.070)+(3.005), (I-749)+(1.070)+(3.006), (I-749)+(1.070)+(3.007), (I-749)+(1.070)+(3.008), (I-749)+(1.070)+(3.009), (I-749)+(1.070)+(3.010), (I-749)+(1.070)+(3.011), (I-749)+(1.070)+(3.012), (I-749)+(1.070)+(3.013), (I-749)+(1.070)+(3.014), (I-749)+(1.070)+(3.015), (I-749)+(1.070)+(3.016), (I-749)+(1.070)+(3.017), (I-749)+(1.070)+(3.018), (I-749)+(1.070)+(3.019), (I-749)+(1.070)+(3.020), (I-749)+(1.070)+(3.021), (I-749)+(1.070)+(3.022), (I-749)+(1.070)+(3.023), (I-749)+(1.070)+(3.024), (I-749)+(1.070)+(3.025), (I-749)+(1.070)+(3.026), (I-749)+(1.070)+(3.027), (I-749)+(1.070)+(3.028), (I-749)+(1.070)+(3.029), (I-749)+(1.070)+(3.030), (I-749)+(1.070)+(3.031), (I-749)+(1.070)+(5.001), (I-749)+(1.070)+(5.002), (I-749)+(1.070)+(5.003), (I-749)+(1.070)+(5.004), (I-749)+(1.070)+(5.005), (I-749)+(1.070)+(5.006), (I-749)+(1.070)+(5.007), (I-749)+(1.070)+(5.008), (I-749)+(1.070)+(5.009), (I-749)+(1.070)+(5.010), (I-749)+(1.070)+(5.011), (I-749)+(1.070)+(5.012), (I-749)+(1.070)+(5.013), (I-749)+(1.070)+(5.014), (I-749)+(1.070)+(5.015), (I-749)+(1.070)+(5.016), (I-749)+(1.070)+(5.017), (I-749)+(1.070)+(5.018), (I-749)+(1.070)+(5.019), (I-749)+(1.070)+(5.020), (I-749)+(1.070)+(5.021), (I-749)+(1.070)+(5.022), (I-749)+(1.070)+(5.023), (I-749)+(1.070)+(6.001), (I-749)+(1.070)+(6.002), (I-749)+(1.070)+(6.003), (I-749)+(1.070)+(6.004), (I-749)+(1.070)+(7.001), (I-749)+(1.070)+(7.002), (I-749)+(1.070)+(7.003), (I-749)+(1.070)+(7.004), (I-749)+(1.070)+(7.005), (I-749)+(1.070)+(7.006), (I-749)+(1.070)+(9.001), (I-749)+(1.070)+(9.002), (I-749)+(1.070)+(9.003), (I-749)+(1.070)+(9.004), (I-749)+(1.070)+(9.005), (I-749)+(1.070)+(9.006), (I-749)+(1.070)+(9.007), (I-749)+(1.070)+(9.008), (I-749)+(1.070)+(9.009), (I-749)+(1.070)+(14.001), (I-749)+(1.070)+(14.002), (I-749)+(1.070)+(15.008), (I-749)+(1.070)+(15.011), (I-749)+(1.070)+(15.012), (I-749)+(1.070)+(15.016), (I-749)+(1.070)+(15.025), (I-749)+(1.070)+(15.027), (I-749)+(1.070)+(15.047), (I-749)+(1.070)+(15.063), (I-749)+(1.070)+(15.064), (I-749)+(1.070)+(16.001), (I-749)+(1.070)+(16.002), (I-749)+(1.070)+(16.003), (I-749)+(1.070)+(16.004), (I-749)+(1.070)+(16.005), (I-749)+(1.070)+(16.006), (I-749)+(1.070)+(16.007), (I-749)+(1.070)+(16.008), (I-749)+(1.070)+(17.001), (I-749)+(1.070)+(17.002), (I-749)+(1.070)+(17.003), (I-749)+(1.070)+(17.004), (I-749)+(1.070)+(17.005), (I-749)+(1.070)+(17.006), (I-749)+(1.070)+(17.007), (I-749)+(1.070)+(17.008), (I-749)+(1.070)+(17.009), (I-749)+(1.070)+(17.010), (I-749)+(1.070)+(17.011), (I-749)+(1.070)+(17.012), (I-749)+(1.070)+(18.001),

(I-749)+(1.071)+(1.072), (I-749)+(1.071)+(1.073), (I-749)+(1.071)+(1.074), (I-749)+(1.071)+(1.075), (I-749)+(1.071)+(1.076), (I-749)+(1.071)+(1.077), (I-749)+(1.071)+(1.078), (I-749)+(1.071)+(1.079), (I-749)+(1.071)+(1.080), (I-749)+(1.071)+(1.081), (I-749)+(1.071)+(1.082), (I-749)+(1.071)+(1.083), (I-749)+(1.071)+(1.084), (I-749)+(1.071)+(1.085), (I-749)+(1.071)+(1.086), (I-749)+(1.071)+(1.087), (I-749)+(1.071)+(1.088), (I-749)+(1.071)+(1.089), (I-749)+(1.071)+(1.090), (I-749)+(1.071)+(1.091), (I-749)+(1.071)+(1.092), (I-749)+(1.071)+(2.001), (I-749)+(1.071)+(2.002), (I-749)+(1.071)+(2.003), (I-749)+(1.071)+(2.004), (I-749)+(1.071)+(2.005), (I-749)+(1.071)+(2.006), (I-749)+(1.071)+(2.007), (I-749)+(1.071)+(2.008), (I-749)+(1.071)+(2.009), (I-749)+(1.071)+(2.010), (I-749)+(1.071)+(2.011), (I-749)+(1.071)+(2.012), (I-749)+(1.071)+(2.013), (I-749)+(1.071)+(2.014), (I-749)+(1.071)+(2.015), (I-749)+(1.071)+(2.016), (I-749)+(1.071)+(2.017), (I-749)+(1.071)+(2.018), (I-749)+(1.071)+(2.019), (I-749)+(1.071)+(2.020), (I-749)+(1.071)+(2.021), (I-749)+(1.071)+(2.022), (I-749)+(1.071)+(2.023), (I-749)+(1.071)+(2.024), (I-749)+(1.071)+(2.025), (I-749)+(1.071)+(2.026), (I-749)+(1.071)+(2.027), (I-749)+(1.071)+(2.028), (I-749)+(1.071)+(2.029), (I-749)+(1.071)+(2.030), (I-749)+(1.071)+(2.031), (I-749)+(1.071)+(2.032), (I-749)+(1.071)+(2.033), (I-749)+(1.071)+(2.034), (I-749)+(1.071)+(2.035), (I-749)+(1.071)+(2.036), (I-749)+(1.071)+(2.037), (I-749)+(1.071)+(2.038), (I-749)+(1.071)+(2.039), (I-749)+(1.071)+(2.040), (I-749)+(1.071)+(2.041), (I-749)+(1.071)+(2.042), (I-749)+(1.071)+(2.043), (I-749)+(1.071)+(2.044), (I-749)+(1.071)+(2.045), (I-749)+(1.071)+(2.046), (I-749)+(1.071)+(2.047), (I-749)+(1.071)+(2.048), (I-749)+(1.071)+(2.049), (I-749)+(1.071)+(2.050), (I-749)+(1.071)+(2.051), (I-749)+(1.071)+(2.052), (I-749)+(1.071)+(2.053), (I-749)+(1.071)+(2.054), (I-749)+(1.071)+(2.055), (I-749)+(1.071)+(2.056), (I-749)+(1.071)+(2.057), (I-749)+(1.071)+(2.058), (I-749)+(1.071)+(2.059), (I-749)+(1.071)+(3.001), (I-749)+(1.071)+(3.002), (I-749)+(1.071)+(3.003), (I-749)+(1.071)+(3.004), (I-749)+(1.071)+(3.005), (I-749)+(1.071)+(3.006), (I-749)+(1.071)+(3.007), (I-749)+(1.071)+(3.008), (I-749)+(1.071)+(3.009), (I-749)+(1.071)+(3.010), (I-749)+(1.071)+(3.011), (I-749)+(1.071)+(3.012), (I-749)+(1.071)+(3.013), (I-749)+(1.071)+(3.014), (I-749)+(1.071)+(3.015), (I-749)+(1.071)+(3.016), (I-749)+(1.071)+(3.017), (I-749)+(1.071)+(3.018), (I-749)+(1.071)+(3.019), (I-749)+(1.071)+(3.020), (I-749)+(1.071)+(3.021), (I-749)+(1.071)+(3.022), (I-749)+(1.071)+(3.023), (I-749)+(1.071)+(3.024), (I-749)+(1.071)+(3.025), (I-749)+(1.071)+(3.026), (I-749)+(1.071)+(3.027), (I-749)+(1.071)+(3.028), (I-749)+(1.071)+(3.029), (I-749)+(1.071)+(3.030), (I-749)+(1.071)+(3.031), (I-749)+(1.071)+(5.001), (I-749)+(1.071)+(5.002), (I-749)+(1.071)+(5.003), (I-749)+(1.071)+(5.004), (I-749)+(1.071)+(5.005), (I-749)+(1.071)+(5.006), (I-749)+(1.071)+(5.007), (I-749)+(1.071)+(5.008), (I-749)+(1.071)+(5.009), (I-749)+(1.071)+(5.010), (I-749)+(1.071)+(5.011), (I-749)+(1.071)+(5.012), (I-749)+(1.071)+(5.013), (I-749)+(1.071)+(5.014), (I-749)+(1.071)+(5.015), (I-749)+(1.071)+(5.016), (I-749)+(1.071)+(5.017), (I-749)+(1.071)+(5.018), (I-749)+(1.071)+(5.019), (I-749)+(1.071)+(5.020), (I-749)+(1.071)+(5.021), (I-749)+(1.071)+(5.022), (I-749)+(1.071)+(5.023), (I-749)+(1.071)+(6.001), (I-749)+(1.071)+(6.002), (I-749)+(1.071)+(6.003), (I-749)+(1.071)+(6.004), (I-749)+(1.071)+(7.001), (I-749)+(1.071)+(7.002), (I-749)+(1.071)+(7.003), (I-749)+(1.071)+(7.004), (I-749)+(1.071)+(7.005), (I-749)+(1.071)+(7.006), (I-749)+(1.071)+(9.001), (I-749)+(1.071)+(9.002), (I-749)+(1.071)+(9.003), (I-749)+(1.071)+(9.004), (I-749)+(1.071)+(9.005), (I-749)+(1.071)+(9.006), (I-749)+(1.071)+(9.007), (I-749)+(1.071)+(9.008), (I-749)+(1.071)+(9.009), (I-749)+(1.071)+(14.001), (I-749)+(1.071)+(14.002), (I-749)+(1.071)+(15.008), (I-749)+(1.071)+(15.011), (I-749)+(1.071)+(15.012), (I-749)+(1.071)+(15.016), (I-749)+(1.071)+(15.025), (I-749)+(1.071)+(15.027), (I-749)+(1.071)+(15.047), (I-749)+(1.071)+(15.063), (I-749)+(1.071)+(15.064), (I-749)+(1.071)+(16.001), (I-749)+(1.071)+(16.002), (I-749)+(1.071)+(16.003), (I-749)+(1.071)+(16.004), (I-749)+(1.071)+(16.005), (I-749)+(1.071)+(16.006), (I-749)+(1.071)+(16.007), (I-749)+(1.071)+(16.008), (I-749)+(1.071)+(17.001), (I-749)+(1.071)+(17.002), (I-749)+(1.071)+(17.003), (I-749)+(1.071)+(17.004), (I-749)+(1.071)+(17.005), (I-749)+(1.071)+(17.006), (I-749)+(1.071)+(17.007), (I-749)+(1.071)+(17.008), (I-749)+(1.071)+(17.009), (I-749)+(1.071)+(17.010), (I-749)+(1.071)+(17.011), (I-749)+(1.071)+(17.012), (I-749)+(1.071)+(18.001),

(I-749)+(1.072)+(1.073), (I-749)+(1.072)+(1.074), (I-749)+(1.072)+(1.075), (I-749)+(1.072)+(1.076), (I-749)+(1.072)+(1.077), (I-749)+(1.072)+(1.078), (I-749)+(1.072)+(1.079), (I-749)+(1.072)+(1.080), (I-749)+(1.072)+(1.081), (I-749)+(1.072)+(1.082), (I-749)+(1.072)+(1.083), (I-749)+(1.072)+(1.084), (I-749)+(1.072)+(1.085), (I-749)+(1.072)+(1.086), (I-749)+(1.072)+(1.087), (I-749)+(1.072)+(1.088), (I-749)+(1.072)+(1.089), (I-749)+(1.072)+(1.090), (I-749)+(1.072)+(1.091), (I-749)+(1.072)+(1.092), (I-749)+(1.072)+(2.001), (I-749)+(1.072)+(2.002), (I-749)+(1.072)+(2.003), (I-749)+(1.072)+(2.004), (I-749)+(1.072)+(2.005), (I-749)+(1.072)+(2.006), (I-749)+(1.072)+(2.007), (I-749)+(1.072)+(2.008), (I-749)+(1.072)+(2.009), (I-749)+(1.072)+(2.010), (I-749)+(1.072)+(2.011), (I-749)+(1.072)+(2.012), (I-749)+(1.072)+(2.013), (I-749)+(1.072)+(2.014), (I-749)+(1.072)+(2.015), (I-749)+(1.072)+(2.016), (I-749)+(1.072)+(2.017), (I-749)+(1.072)+(2.018), (I-749)+(1.072)+(2.019), (I-749)+(1.072)+(2.020), (I-749)+(1.072)+(2.021), (I-749)+(1.072)+(2.022), (I-749)+(1.072)+(2.023), (I-749)+(1.072)+(2.024), (I-749)+(1.072)+(2.025), (I-749)+(1.072)+(2.026), (I-749)+(1.072)+(2.027), (I-749)+(1.072)+(2.028), (I-749)+(1.072)+(2.029), (I-749)+(1.072)+(2.030), (I-749)+(1.072)+(2.031), (I-749)+(1.072)+(2.032), (I-749)+(1.072)+(2.033), (I-749)+(1.072)+(2.034), (I-749)+(1.072)+(2.035), (I-749)+(1.072)+(2.036), (I-749)+(1.072)+(2.037), (I-749)+(1.072)+(2.038), (I-749)+(1.072)+(2.039), (I-749)+(1.072)+(2.040), (I-749)+(1.072)+(2.041), (I-749)+(1.072)+(2.042), (I-749)+(1.072)+(2.043), (I-749)+(1.072)+(2.044), (I-749)+(1.072)+(2.045), (I-749)+(1.072)+(2.046), (I-749)+(1.072)+(2.047), (I-749)+(1.072)+(2.048), (I-749)+(1.072)+(2.049), (I-749)+(1.072)+(2.050), (I-749)+(1.072)+(2.051), (I-749)+(1.072)+(2.052), (I-749)+(1.072)+(2.053), (I-749)+(1.072)+(2.054), (I-749)+(1.072)+(2.055), (I-749)+(1.072)+(2.056), (I-749)+(1.072)+(2.057), (I-749)+(1.072)+(2.058), (I-749)+(1.072)+(2.059), (I-749)+(1.072)+(3.001), (I-749)+(1.072)+(3.002), (I-749)+(1.072)+(3.003), (I-749)+(1.072)+(3.004), (I-749)+(1.072)+(3.005), (I-749)+(1.072)+(3.006), (I-749)+(1.072)+(3.007), (I-749)+(1.072)+(3.008), (I-749)+(1.072)+(3.009), (I-749)+(1.072)+(3.010), (I-749)+(1.072)+(3.011), (I-749)+(1.072)+(3.012), (I-749)+(1.072)+(3.013), (I-749)+(1.072)+(3.014), (I-749)+(1.072)+(3.015), (I-749)+(1.072)+(3.016), (I-749)+(1.072)+(3.017), (I-749)+(1.072)+(3.018), (I-749)+(1.072)+(3.019), (I-749)+(1.072)+(3.020), (I-749)+(1.072)+(3.021), (I-749)+(1.072)+(3.022), (I-749)+(1.072)+(3.023), (I-749)+(1.072)+(3.024), (I-749)+(1.072)+(3.025), (I-749)+(1.072)+(3.026), (I-749)+(1.072)+(3.027), (I-749)+(1.072)+(3.028), (I-749)+(1.072)+(3.029), (I-749)+(1.072)+(3.030), (I-749)+(1.072)+(3.031), (I-749)+(1.072)+(5.001), (I-749)+(1.072)+(5.002), (I-749)+(1.072)+(5.003), (I-749)+(1.072)+(5.004), (I-749)+(1.072)+(5.005), (I-749)+(1.072)+(5.006), (I-749)+(1.072)+(5.007), (I-749)+(1.072)+(5.008), (I-749)+(1.072)+(5.009), (I-749)+(1.072)+(5.010), (I-749)+(1.072)+(5.011), (I-749)+(1.072)+(5.012), (I-749)+(1.072)+(5.013), (I-749)+(1.072)+(5.014), (I-749)+(1.072)+(5.015), (I-749)+(1.072)+(5.016), (I-749)+(1.072)+(5.017), (I-749)+(1.072)+(5.018), (I-749)+(1.072)+(5.019), (I-749)+(1.072)+(5.020), (I-749)+(1.072)+(5.021), (I-749)+(1.072)+(5.022), (I-749)+(1.072)+(5.023), (I-749)+(1.072)+(6.001), (I-749)+(1.072)+(6.002), (I-749)+(1.072)+(6.003), (I-749)+(1.072)+(6.004), (I-749)+(1.072)+(7.001), (I-749)+(1.072)+(7.002), (I-749)+(1.072)+(7.003), (I-749)+(1.072)+(7.004), (I-749)+(1.072)+(7.005), (I-749)+(1.072)+(7.006), (I-749)+(1.072)+(9.001), (I-749)+(1.072)+(9.002), (I-749)+(1.072)+(9.003), (I-749)+(1.072)+(9.004), (I-749)+(1.072)+(9.005), (I-749)+(1.072)+(9.006), (I-749)+(1.072)+(9.007), (I-749)+(1.072)+(9.008), (I-749)+(1.072)+(9.009), (I-749)+(1.072)+(14.001), (I-749)+(1.072)+(14.002), (I-749)+(1.072)+(15.008), (I-749)+(1.072)+(15.011), (I-749)+(1.072)+(15.012), (I-749)+(1.072)+(15.016), (I-749)+(1.072)+(15.025), (I-749)+(1.072)+(15.027), (I-749)+(1.072)+(15.047), (I-749)+(1.072)+(15.063), (I-749)+(1.072)+(15.064), (I-749)+(1.072)+(16.001), (I-749)+(1.072)+(16.002), (I-749)+(1.072)+(16.003), (I-749)+(1.072)+(16.004), (I-749)+(1.072)+(16.005), (I-749)+(1.072)+(16.006), (I-749)+(1.072)+(16.007), (I-749)+(1.072)+(16.008), (I-749)+(1.072)+(17.001), (I-749)+(1.072)+(17.002), (I-749)+(1.072)+(17.003), (I-749)+(1.072)+(17.004), (I-749)+(1.072)+(17.005), (I-749)+(1.072)+(17.006), (I-749)+(1.072)+(17.007), (I-749)+(1.072)+(17.008), (I-749)+(1.072)+(17.009), (I-749)+(1.072)+(17.010), (I-749)+(1.072)+(17.011), (I-749)+(1.072)+(17.012), (I-749)+(1.072)+(18.001),

(I-749)+(1.073)+(1.074), (I-749)+(1.073)+(1.075), (I-749)+(1.073)+(1.076), (I-749)+(1.073)+(1.077), (I-749)+(1.073)+(1.078), (I-749)+(1.073)+(1.079), (I-749)+(1.073)+(1.080), (I-749)+(1.073)+(1.081), (I-749)+(1.073)+(1.082), (I-749)+(1.073)+(1.083), (I-749)+(1.073)+(1.084), (I-749)+(1.073)+(1.085), (I-749)+(1.073)+(1.086), (I-749)+(1.073)+(1.087), (I-749)+(1.073)+(1.088), (I-749)+(1.073)+(1.089), (I-749)+(1.073)+(1.090), (I-749)+(1.073)+(1.091), (I-749)+(1.073)+(1.092), (I-749)+(1.073)+(2.001), (I-749)+(1.073)+(2.002), (I-749)+(1.073)+(2.003), (I-749)+(1.073)+(2.004), (I-749)+(1.073)+(2.005), (I-749)+(1.073)+(2.006), (I-749)+(1.073)+(2.007), (I-749)+(1.073)+(2.008), (I-749)+(1.073)+(2.009), (I-749)+(1.073)+(2.010), (I-749)+(1.073)+(2.011), (I-749)+(1.073)+(2.012), (I-749)+(1.073)+(2.013), (I-749)+(1.073)+(2.014), (I-749)+(1.073)+(2.015), (I-749)+(1.073)+(2.016), (I-749)+(1.073)+(2.017), (I-749)+(1.073)+(2.018), (I-749)+(1.073)+(2.019), (I-749)+(1.073)+(2.020), (I-749)+(1.073)+(2.021), (I-749)+(1.073)+(2.022), (I-749)+(1.073)+(2.023), (I-749)+(1.073)+(2.024), (I-749)+(1.073)+(2.025), (I-749)+(1.073)+(2.026), (I-749)+(1.073)+(2.027), (I-749)+(1.073)+(2.028), (I-749)+(1.073)+(2.029), (I-749)+(1.073)+(2.030), (I-749)+(1.073)+(2.031), (I-749)+(1.073)+(2.032), (I-749)+(1.073)+(2.033), (I-749)+(1.073)+(2.034), (I-749)+(1.073)+(2.035), (I-749)+(1.073)+(2.036), (I-749)+(1.073)+(2.037), (I-749)+(1.073)+(2.038), (I-749)+(1.073)+(2.039), (I-749)+(1.073)+(2.040), (I-749)+(1.073)+(2.041), (I-749)+(1.073)+(2.042), (I-749)+(1.073)+(2.043), (I-749)+(1.073)+(2.044), (I-749)+(1.073)+(2.045), (I-749)+(1.073)+(2.046), (I-749)+(1.073)+(2.047), (I-749)+(1.073)+(2.048), (I-749)+(1.073)+(2.049), (I-749)+(1.073)+(2.050), (I-749)+(1.073)+(2.051), (I-749)+(1.073)+(2.052), (I-749)+(1.073)+(2.053), (I-749)+(1.073)+(2.054), (I-749)+(1.073)+(2.055), (I-749)+(1.073)+(2.056), (I-749)+(1.073)+(2.057), (I-749)+(1.073)+(2.058), (I-749)+(1.073)+(2.059), (I-749)+(1.073)+(3.001), (I-749)+(1.073)+(3.002), (I-749)+(1.073)+(3.003), (I-749)+(1.073)+(3.004), (I-749)+(1.073)+(3.005), (I-749)+(1.073)+(3.006), (I-749)+(1.073)+(3.007), (I-749)+(1.073)+(3.008), (I-749)+(1.073)+(3.009), (I-749)+(1.073)+(3.010), (I-749)+(1.073)+(3.011), (I-749)+(1.073)+(3.012), (I-749)+(1.073)+(3.013), (I-749)+(1.073)+(3.014), (I-749)+(1.073)+(3.015), (I-749)+(1.073)+(3.016), (I-749)+(1.073)+(3.017), (I-749)+(1.073)+(3.018), (I-749)+(1.073)+(3.019), (I-749)+(1.073)+(3.020), (I-749)+(1.073)+(3.021), (I-749)+(1.073)+(3.022), (I-749)+(1.073)+(3.023), (I-749)+(1.073)+(3.024), (I-749)+(1.073)+(3.025), (I-749)+(1.073)+(3.026), (I-749)+(1.073)+(3.027), (I-749)+(1.073)+(3.028), (I-749)+(1.073)+(3.029), (I-749)+(1.073)+(3.030), (I-749)+(1.073)+(3.031), (I-749)+(1.073)+(5.001), (I-749)+(1.073)+(5.002), (I-749)+(1.073)+(5.003), (I-749)+(1.073)+(5.004), (I-749)+(1.073)+(5.005), (I-749)+(1.073)+(5.006), (I-749)+(1.073)+(5.007), (I-749)+(1.073)+(5.008), (I-749)+(1.073)+(5.009), (I-749)+(1.073)+(5.010), (I-749)+(1.073)+(5.011), (I-749)+(1.073)+(5.012), (I-749)+(1.073)+(5.013), (I-749)+(1.073)+(5.014), (I-749)+(1.073)+(5.015), (I-749)+(1.073)+(5.016), (I-749)+(1.073)+(5.017), (I-749)+(1.073)+(5.018), (I-749)+(1.073)+(5.019), (I-749)+(1.073)+(5.020), (I-749)+(1.073)+(5.021), (I-749)+(1.073)+(5.022), (I-749)+(1.073)+(5.023), (I-749)+(1.073)+(6.001), (I-749)+(1.073)+(6.002), (I-749)+(1.073)+(6.003), (I-749)+(1.073)+(6.004), (I-749)+(1.073)+(7.001), (I-749)+(1.073)+(7.002), (I-749)+(1.073)+(7.003), (I-749)+(1.073)+(7.004), (I-749)+(1.073)+(7.005), (I-749)+(1.073)+(7.006), (I-749)+(1.073)+(9.001), (I-749)+(1.073)+(9.002), (I-749)+(1.073)+(9.003), (I-749)+(1.073)+(9.004), (I-749)+(1.073)+(9.005), (I-749)+(1.073)+(9.006), (I-749)+(1.073)+(9.007), (I-749)+(1.073)+(9.008), (I-749)+(1.073)+(9.009), (I-749)+(1.073)+(14.001), (I-749)+(1.073)+(14.002), (I-749)+(1.073)+(15.008), (I-749)+(1.073)+(15.011), (I-749)+(1.073)+(15.012), (I-749)+(1.073)+(15.016), (I-749)+(1.073)+(15.025), (I-749)+(1.073)+(15.027), (I-749)+(1.073)+(15.047), (I-749)+(1.073)+(15.063), (I-749)+(1.073)+(15.064), (I-749)+(1.073)+(16.001), (I-749)+(1.073)+(16.002), (I-749)+(1.073)+(16.003), (I-749)+(1.073)+(16.004), (I-749)+(1.073)+(16.005), (I-749)+(1.073)+(16.006), (I-749)+(1.073)+(16.007), (I-749)+(1.073)+(16.008), (I-749)+(1.073)+(17.001), (I-749)+(1.073)+(17.002), (I-749)+(1.073)+(17.003), (I-749)+(1.073)+(17.004), (I-749)+(1.073)+(17.005), (I-749)+(1.073)+(17.006), (I-749)+(1.073)+(17.007), (I-749)+(1.073)+(17.008), (I-749)+(1.073)+(17.009), (I-749)+(1.073)+(17.010), (I-749)+(1.073)+(17.011), (I-749)+(1.073)+(17.012), (I-749)+(1.073)+(18.001),

(I-749)+(1.074)+(1.075), (I-749)+(1.074)+(1.076), (I-749)+(1.074)+(1.077), (I-749)+(1.074)+(1.078), (I-749)+(1.074)+(1.079), (I-749)+(1.074)+(1.080), (I-749)+(1.074)+(1.081), (I-749)+(1.074)+(1.082), (I-749)+(1.074)+(1.083), (I-749)+(1.074)+(1.084), (I-749)+(1.074)+(1.085), (I-749)+(1.074)+(1.086), (I-749)+(1.074)+(1.087), (I-749)+(1.074)+(1.088), (I-749)+(1.074)+(1.089), (I-749)+(1.074)+(1.090), (I-749)+(1.074)+(1.091), (I-749)+(1.074)+(1.092), (I-749)+(1.074)+(2.001), (I-749)+(1.074)+(2.002), (I-749)+(1.074)+(2.003), (I-749)+(1.074)+(2.004), (I-749)+(1.074)+(2.005), (I-749)+(1.074)+(2.006), (I-749)+(1.074)+(2.007), (I-749)+(1.074)+(2.008), (I-749)+(1.074)+(2.009), (I-749)+(1.074)+(2.010), (I-749)+(1.074)+(2.011), (I-749)+(1.074)+(2.012), (I-749)+(1.074)+(2.013), (I-749)+(1.074)+(2.014), (I-749)+(1.074)+(2.015), (I-749)+(1.074)+(2.016), (I-749)+(1.074)+(2.017), (I-749)+(1.074)+(2.018), (I-749)+(1.074)+(2.019), (I-749)+(1.074)+(2.020), (I-749)+(1.074)+(2.021), (I-749)+(1.074)+(2.022), (I-749)+(1.074)+(2.023), (I-749)+(1.074)+(2.024), (I-749)+(1.074)+(2.025), (I-749)+(1.074)+(2.026), (I-749)+(1.074)+(2.027), (I-749)+(1.074)+(2.028), (I-749)+(1.074)+(2.029), (I-749)+(1.074)+(2.030), (I-749)+(1.074)+(2.031), (I-749)+(1.074)+(2.032), (I-749)+(1.074)+(2.033), (I-749)+(1.074)+(2.034), (I-749)+(1.074)+(2.035), (I-749)+(1.074)+(2.036), (I-749)+(1.074)+(2.037), (I-749)+(1.074)+(2.038), (I-749)+(1.074)+(2.039), (I-749)+(1.074)+(2.040), (I-749)+(1.074)+(2.041), (I-749)+(1.074)+(2.042), (I-749)+(1.074)+(2.043), (I-749)+(1.074)+(2.044), (I-749)+(1.074)+(2.045), (I-749)+(1.074)+(2.046), (I-749)+(1.074)+(2.047), (I-749)+(1.074)+(2.048), (I-749)+(1.074)+(2.049), (I-749)+(1.074)+(2.050), (I-749)+(1.074)+(2.051), (I-749)+(1.074)+(2.052), (I-749)+(1.074)+(2.053), (I-749)+(1.074)+(2.054), (I-749)+(1.074)+(2.055), (I-749)+(1.074)+(2.056), (I-749)+(1.074)+(2.057), (I-749)+(1.074)+(2.058), (I-749)+(1.074)+(2.059), (I-749)+(1.074)+(3.001), (I-749)+(1.074)+(3.002), (I-749)+(1.074)+(3.003), (I-749)+(1.074)+(3.004), (I-749)+(1.074)+(3.005), (I-749)+(1.074)+(3.006), (I-749)+(1.074)+(3.007), (I-749)+(1.074)+(3.008), (I-749)+(1.074)+(3.009), (I-749)+(1.074)+(3.010), (I-749)+(1.074)+(3.011), (I-749)+(1.074)+(3.012), (I-749)+(1.074)+(3.013), (I-749)+(1.074)+(3.014), (I-749)+(1.074)+(3.015), (I-749)+(1.074)+(3.016), (I-749)+(1.074)+(3.017), (I-749)+(1.074)+(3.018), (I-749)+(1.074)+(3.019), (I-749)+(1.074)+(3.020), (I-749)+(1.074)+(3.021), (I-749)+(1.074)+(3.022), (I-749)+(1.074)+(3.023), (I-749)+(1.074)+(3.024), (I-749)+(1.074)+(3.025), (I-749)+(1.074)+(3.026), (I-749)+(1.074)+(3.027), (I-749)+(1.074)+(3.028), (I-749)+(1.074)+(3.029), (I-749)+(1.074)+(3.030), (I-749)+(1.074)+(3.031), (I-749)+(1.074)+(5.001), (I-749)+(1.074)+(5.002), (I-749)+(1.074)+(5.003), (I-749)+(1.074)+(5.004), (I-749)+(1.074)+(5.005), (I-749)+(1.074)+(5.006), (I-749)+(1.074)+(5.007), (I-749)+(1.074)+(5.008), (I-749)+(1.074)+(5.009), (I-749)+(1.074)+(5.010), (I-749)+(1.074)+(5.011), (I-749)+(1.074)+(5.012), (I-749)+(1.074)+(5.013), (I-749)+(1.074)+(5.014), (I-749)+(1.074)+(5.015), (I-749)+(1.074)+(5.016), (I-749)+(1.074)+(5.017), (I-749)+(1.074)+(5.018), (I-749)+(1.074)+(5.019), (I-749)+(1.074)+(5.020), (I-749)+(1.074)+(5.021), (I-749)+(1.074)+(5.022), (I-749)+(1.074)+(5.023), (I-749)+(1.074)+(6.001), (I-749)+(1.074)+(6.002), (I-749)+(1.074)+(6.003), (I-749)+(1.074)+(6.004), (I-749)+(1.074)+(7.001), (I-749)+(1.074)+(7.002), (I-749)+(1.074)+(7.003), (I-749)+(1.074)+(7.004), (I-749)+(1.074)+(7.005), (I-749)+(1.074)+(7.006), (I-749)+(1.074)+(9.001), (I-749)+(1.074)+(9.002), (I-749)+(1.074)+(9.003), (I-749)+(1.074)+(9.004), (I-749)+(1.074)+(9.005), (I-749)+(1.074)+(9.006), (I-749)+(1.074)+(9.007), (I-749)+(1.074)+(9.008), (I-749)+(1.074)+(9.009), (I-749)+(1.074)+(14.001), (I-749)+(1.074)+(14.002), (I-749)+(1.074)+(15.008), (I-749)+(1.074)+(15.011), (I-749)+(1.074)+(15.012), (I-749)+(1.074)+(15.016), (I-749)+(1.074)+(15.025), (I-749)+(1.074)+(15.027), (I-749)+(1.074)+(15.047), (I-749)+(1.074)+(15.063), (I-749)+(1.074)+(15.064), (I-749)+(1.074)+(16.001), (I-749)+(1.074)+(16.002), (I-749)+(1.074)+(16.003), (I-749)+(1.074)+(16.004), (I-749)+(1.074)+(16.005), (I-749)+(1.074)+(16.006), (I-749)+(1.074)+(16.007), (I-749)+(1.074)+(16.008), (I-749)+(1.074)+(17.001), (I-749)+(1.074)+(17.002), (I-749)+(1.074)+(17.003), (I-749)+(1.074)+(17.004), (I-749)+(1.074)+(17.005), (I-749)+(1.074)+(17.006), (I-749)+(1.074)+(17.007), (I-749)+(1.074)+(17.008), (I-749)+(1.074)+(17.009), (I-749)+(1.074)+(17.010), (I-749)+(1.074)+(17.011), (I-749)+(1.074)+(17.012), (I-749)+(1.074)+(18.001),

(I-749)+(1.075)+(1.076), (I-749)+(1.075)+(1.077), (I-749)+(1.075)+(1.078), (I-749)+(1.075)+(1.079), (I-749)+(1.075)+(1.080), (I-749)+(1.075)+(1.081), (I-749)+(1.075)+(1.082), (I-749)+(1.075)+(1.083), (I-749)+(1.075)+(1.084), (I-749)+(1.075)+(1.085), (I-749)+(1.075)+(1.086), (I-749)+(1.075)+(1.087), (I-749)+(1.075)+(1.088), (I-749)+(1.075)+(1.089), (I-749)+(1.075)+(1.090), (I-749)+(1.075)+(1.091), (I-749)+(1.075)+(1.092), (I-749)+(1.075)+(2.001), (I-749)+(1.075)+(2.002), (I-749)+(1.075)+(2.003), (I-749)+(1.075)+(2.004), (I-749)+(1.075)+(2.005), (I-749)+(1.075)+(2.006), (I-749)+(1.075)+(2.007), (I-749)+(1.075)+(2.008), (I-749)+(1.075)+(2.009), (I-749)+(1.075)+(2.010), (I-749)+(1.075)+(2.011), (I-749)+(1.075)+(2.012), (I-749)+(1.075)+(2.013), (I-749)+(1.075)+(2.014), (I-749)+(1.075)+(2.015), (I-749)+(1.075)+(2.016), (I-749)+(1.075)+(2.017), (I-749)+(1.075)+(2.018), (I-749)+(1.075)+(2.019), (I-749)+(1.075)+(2.020), (I-749)+(1.075)+(2.021), (I-749)+(1.075)+(2.022), (I-749)+(1.075)+(2.023), (I-749)+(1.075)+(2.024), (I-749)+(1.075)+(2.025), (I-749)+(1.075)+(2.026), (I-749)+(1.075)+(2.027), (I-749)+(1.075)+(2.028), (I-749)+(1.075)+(2.029), (I-749)+(1.075)+(2.030), (I-749)+(1.075)+(2.031), (I-749)+(1.075)+(2.032), (I-749)+(1.075)+(2.033), (I-749)+(1.075)+(2.034), (I-749)+(1.075)+(2.035), (I-749)+(1.075)+(2.036), (I-749)+(1.075)+(2.037), (I-749)+(1.075)+(2.038), (I-749)+(1.075)+(2.039), (I-749)+(1.075)+(2.040), (I-749)+(1.075)+(2.041), (I-749)+(1.075)+(2.042), (I-749)+(1.075)+(2.043), (I-749)+(1.075)+(2.044), (I-749)+(1.075)+(2.045), (I-749)+(1.075)+(2.046), (I-749)+(1.075)+(2.047), (I-749)+(1.075)+(2.048), (I-749)+(1.075)+(2.049), (I-749)+(1.075)+(2.050), (I-749)+(1.075)+(2.051), (I-749)+(1.075)+(2.052), (I-749)+(1.075)+(2.053), (I-749)+(1.075)+(2.054), (I-749)+(1.075)+(2.055), (I-749)+(1.075)+(2.056), (I-749)+(1.075)+(2.057), (I-749)+(1.075)+(2.058), (I-749)+(1.075)+(2.059), (I-749)+(1.075)+(3.001), (I-749)+(1.075)+(3.002), (I-749)+(1.075)+(3.003), (I-749)+(1.075)+(3.004), (I-749)+(1.075)+(3.005), (I-749)+(1.075)+(3.006), (I-749)+(1.075)+(3.007), (I-749)+(1.075)+(3.008), (I-749)+(1.075)+(3.009), (I-749)+(1.075)+(3.010), (I-749)+(1.075)+(3.011), (I-749)+(1.075)+(3.012), (I-749)+(1.075)+(3.013), (I-749)+(1.075)+(3.014), (I-749)+(1.075)+(3.015), (I-749)+(1.075)+(3.016), (I-749)+(1.075)+(3.017), (I-749)+(1.075)+(3.018), (I-749)+(1.075)+(3.019), (I-749)+(1.075)+(3.020), (I-749)+(1.075)+(3.021), (I-749)+(1.075)+(3.022), (I-749)+(1.075)+(3.023), (I-749)+(1.075)+(3.024), (I-749)+(1.075)+(3.025), (I-749)+(1.075)+(3.026), (I-749)+(1.075)+(3.027), (I-749)+(1.075)+(3.028), (I-749)+(1.075)+(3.029), (I-749)+(1.075)+(3.030), (I-749)+(1.075)+(3.031), (I-749)+(1.075)+(5.001), (I-749)+(1.075)+(5.002), (I-749)+(1.075)+(5.003), (I-749)+(1.075)+(5.004), (I-749)+(1.075)+(5.005), (I-749)+(1.075)+(5.006), (I-749)+(1.075)+(5.007), (I-749)+(1.075)+(5.008), (I-749)+(1.075)+(5.009), (I-749)+(1.075)+(5.010), (I-749)+(1.075)+(5.011), (I-749)+(1.075)+(5.012), (I-749)+(1.075)+(5.013), (I-749)+(1.075)+(5.014), (I-749)+(1.075)+(5.015), (I-749)+(1.075)+(5.016), (I-749)+(1.075)+(5.017), (I-749)+(1.075)+(5.018), (I-749)+(1.075)+(5.019), (I-749)+(1.075)+(5.020), (I-749)+(1.075)+(5.021), (I-749)+(1.075)+(5.022), (I-749)+(1.075)+(5.023), (I-749)+(1.075)+(6.001), (I-749)+(1.075)+(6.002), (I-749)+(1.075)+(6.003), (I-749)+(1.075)+(6.004), (I-749)+(1.075)+(7.001), (I-749)+(1.075)+(7.002), (I-749)+(1.075)+(7.003), (I-749)+(1.075)+(7.004), (I-749)+(1.075)+(7.005), (I-749)+(1.075)+(7.006), (I-749)+(1.075)+(9.001), (I-749)+(1.075)+(9.002), (I-749)+(1.075)+(9.003), (I-749)+(1.075)+(9.004), (I-749)+(1.075)+(9.005), (I-749)+(1.075)+(9.006), (I-749)+(1.075)+(9.007), (I-749)+(1.075)+(9.008), (I-749)+(1.075)+(9.009), (I-749)+(1.075)+(14.001), (I-749)+(1.075)+(14.002), (I-749)+(1.075)+(15.008), (I-749)+(1.075)+(15.011), (I-749)+(1.075)+(15.012), (I-749)+(1.075)+(15.016), (I-749)+(1.075)+(15.025), (I-749)+(1.075)+(15.027), (I-749)+(1.075)+(15.047), (I-749)+(1.075)+(15.063), (I-749)+(1.075)+(15.064), (I-749)+(1.075)+(16.001), (I-749)+(1.075)+(16.002), (I-749)+(1.075)+(16.003), (I-749)+(1.075)+(16.004), (I-749)+(1.075)+(16.005), (I-749)+(1.075)+(16.006), (I-749)+(1.075)+(16.007), (I-749)+(1.075)+(16.008), (I-749)+(1.075)+(17.001), (I-749)+(1.075)+(17.002), (I-749)+(1.075)+(17.003), (I-749)+(1.075)+(17.004), (I-749)+(1.075)+(17.005), (I-749)+(1.075)+(17.006), (I-749)+(1.075)+(17.007), (I-749)+(1.075)+(17.008), (I-749)+(1.075)+(17.009), (I-749)+(1.075)+(17.010), (I-749)+(1.075)+(17.011), (I-749)+(1.075)+(17.012), (I-749)+(1.075)+(18.001),

(I-749)+(1.076)+(1.077), (I-749)+(1.076)+(1.078), (I-749)+(1.076)+(1.079), (I-749)+(1.076)+(1.080), (I-749)+(1.076)+(1.081), (I-749)+(1.076)+(1.082), (I-749)+(1.076)+(1.083), (I-749)+(1.076)+(1.084), (I-749)+(1.076)+(1.085), (I-749)+(1.076)+(1.086), (I-749)+(1.076)+(1.087), (I-749)+(1.076)+(1.088), (I-749)+(1.076)+(1.089), (I-749)+(1.076)+(1.090), (I-749)+(1.076)+(1.091), (I-749)+(1.076)+(1.092), (I-749)+(1.076)+(2.001), (I-749)+(1.076)+(2.002), (I-749)+(1.076)+(2.003), (I-749)+(1.076)+(2.004), (I-749)+(1.076)+(2.005), (I-749)+(1.076)+(2.006), (I-749)+(1.076)+(2.007), (I-749)+(1.076)+(2.008), (I-749)+(1.076)+(2.009), (I-749)+(1.076)+(2.010), (I-749)+(1.076)+(2.011), (I-749)+(1.076)+(2.012), (I-749)+(1.076)+(2.013), (I-749)+(1.076)+(2.014), (I-749)+(1.076)+(2.015), (I-749)+(1.076)+(2.016), (I-749)+(1.076)+(2.017), (I-749)+(1.076)+(2.018), (I-749)+(1.076)+(2.019), (I-749)+(1.076)+(2.020), (I-749)+(1.076)+(2.021), (I-749)+(1.076)+(2.022), (I-749)+(1.076)+(2.023), (I-749)+(1.076)+(2.024), (I-749)+(1.076)+(2.025), (I-749)+(1.076)+(2.026), (I-749)+(1.076)+(2.027), (I-749)+(1.076)+(2.028), (I-749)+(1.076)+(2.029), (I-749)+(1.076)+(2.030), (I-749)+(1.076)+(2.031), (I-749)+(1.076)+(2.032), (I-749)+(1.076)+(2.033), (I-749)+(1.076)+(2.034), (I-749)+(1.076)+(2.035), (I-749)+(1.076)+(2.036), (I-749)+(1.076)+(2.037), (I-749)+(1.076)+(2.038), (I-749)+(1.076)+(2.039), (I-749)+(1.076)+(2.040), (I-749)+(1.076)+(2.041), (I-749)+(1.076)+(2.042), (I-749)+(1.076)+(2.043), (I-749)+(1.076)+(2.044), (I-749)+(1.076)+(2.045), (I-749)+(1.076)+(2.046), (I-749)+(1.076)+(2.047), (I-749)+(1.076)+(2.048), (I-749)+(1.076)+(2.049), (I-749)+(1.076)+(2.050), (I-749)+(1.076)+(2.051), (I-749)+(1.076)+(2.052), (I-749)+(1.076)+(2.053), (I-749)+(1.076)+(2.054), (I-749)+(1.076)+(2.055), (I-749)+(1.076)+(2.056), (I-749)+(1.076)+(2.057), (I-749)+(1.076)+(2.058), (I-749)+(1.076)+(2.059), (I-749)+(1.076)+(3.001), (I-749)+(1.076)+(3.002), (I-749)+(1.076)+(3.003), (I-749)+(1.076)+(3.004), (I-749)+(1.076)+(3.005), (I-749)+(1.076)+(3.006), (I-749)+(1.076)+(3.007), (I-749)+(1.076)+(3.008), (I-749)+(1.076)+(3.009), (I-749)+(1.076)+(3.010), (I-749)+(1.076)+(3.011), (I-749)+(1.076)+(3.012), (I-749)+(1.076)+(3.013), (I-749)+(1.076)+(3.014), (I-749)+(1.076)+(3.015), (I-749)+(1.076)+(3.016), (I-749)+(1.076)+(3.017), (I-749)+(1.076)+(3.018), (I-749)+(1.076)+(3.019), (I-749)+(1.076)+(3.020), (I-749)+(1.076)+(3.021), (I-749)+(1.076)+(3.022), (I-749)+(1.076)+(3.023), (I-749)+(1.076)+(3.024), (I-749)+(1.076)+(3.025), (I-749)+(1.076)+(3.026), (I-749)+(1.076)+(3.027), (I-749)+(1.076)+(3.028), (I-749)+(1.076)+(3.029), (I-749)+(1.076)+(3.030), (I-749)+(1.076)+(3.031), (I-749)+(1.076)+(5.001), (I-749)+(1.076)+(5.002), (I-749)+(1.076)+(5.003), (I-749)+(1.076)+(5.004), (I-749)+(1.076)+(5.005), (I-749)+(1.076)+(5.006), (I-749)+(1.076)+(5.007), (I-749)+(1.076)+(5.008), (I-749)+(1.076)+(5.009), (I-749)+(1.076)+(5.010), (I-749)+(1.076)+(5.011), (I-749)+(1.076)+(5.012), (I-749)+(1.076)+(5.013), (I-749)+(1.076)+(5.014), (I-749)+(1.076)+(5.015), (I-749)+(1.076)+(5.016), (I-749)+(1.076)+(5.017), (I-749)+(1.076)+(5.018), (I-749)+(1.076)+(5.019), (I-749)+(1.076)+(5.020), (I-749)+(1.076)+(5.021), (I-749)+(1.076)+(5.022), (I-749)+(1.076)+(5.023), (I-749)+(1.076)+(6.001), (I-749)+(1.076)+(6.002), (I-749)+(1.076)+(6.003), (I-749)+(1.076)+(6.004), (I-749)+(1.076)+(7.001), (I-749)+(1.076)+(7.002), (I-749)+(1.076)+(7.003), (I-749)+(1.076)+(7.004), (I-749)+(1.076)+(7.005), (I-749)+(1.076)+(7.006), (I-749)+(1.076)+(9.001), (I-749)+(1.076)+(9.002), (I-749)+(1.076)+(9.003), (I-749)+(1.076)+(9.004), (I-749)+(1.076)+(9.005), (I-749)+(1.076)+(9.006), (I-749)+(1.076)+(9.007), (I-749)+(1.076)+(9.008), (I-749)+(1.076)+(9.009), (I-749)+(1.076)+(14.001), (I-749)+(1.076)+(14.002), (I-749)+(1.076)+(15.008), (I-749)+(1.076)+(15.011), (I-749)+(1.076)+(15.012), (I-749)+(1.076)+(15.016), (I-749)+(1.076)+(15.025), (I-749)+(1.076)+(15.027), (I-749)+(1.076)+(15.047), (I-749)+(1.076)+(15.063), (I-749)+(1.076)+(15.064), (I-749)+(1.076)+(16.001), (I-749)+(1.076)+(16.002), (I-749)+(1.076)+(16.003), (I-749)+(1.076)+(16.004), (I-749)+(1.076)+(16.005), (I-749)+(1.076)+(16.006), (I-749)+(1.076)+(16.007), (I-749)+(1.076)+(16.008), (I-749)+(1.076)+(17.001), (I-749)+(1.076)+(17.002), (I-749)+(1.076)+(17.003), (I-749)+(1.076)+(17.004), (I-749)+(1.076)+(17.005), (I-749)+(1.076)+(17.006), (I-749)+(1.076)+(17.007), (I-749)+(1.076)+(17.008), (I-749)+(1.076)+(17.009), (I-749)+(1.076)+(17.010), (I-749)+(1.076)+(17.011), (I-749)+(1.076)+(17.012), (I-749)+(1.076)+(18.001),

(I-749)+(1.077)+(1.078), (I-749)+(1.077)+(1.079), (I-749)+(1.077)+(1.080), (I-749)+(1.077)+(1.081), (I-749)+(1.077)+(1.082), (I-749)+(1.077)+(1.083), (I-749)+(1.077)+(1.084), (I-749)+(1.077)+(1.085), (I-749)+(1.077)+(1.086), (I-749)+(1.077)+(1.087), (I-749)+(1.077)+(1.088), (I-749)+(1.077)+(1.089), (I-749)+(1.077)+(1.090), (I-749)+(1.077)+(1.091), (I-749)+(1.077)+(1.092), (I-749)+(1.077)+(2.001), (I-749)+(1.077)+(2.002), (I-749)+(1.077)+(2.003), (I-749)+(1.077)+(2.004), (I-749)+(1.077)+(2.005), (I-749)+(1.077)+(2.006), (I-749)+(1.077)+(2.007), (I-749)+(1.077)+(2.008), (I-749)+(1.077)+(2.009), (I-749)+(1.077)+(2.010), (I-749)+(1.077)+(2.011), (I-749)+(1.077)+(2.012), (I-749)+(1.077)+(2.013), (I-749)+(1.077)+(2.014), (I-749)+(1.077)+(2.015), (I-749)+(1.077)+(2.016), (I-749)+(1.077)+(2.017), (I-749)+(1.077)+(2.018), (I-749)+(1.077)+(2.019), (I-749)+(1.077)+(2.020), (I-749)+(1.077)+(2.021), (I-749)+(1.077)+(2.022), (I-749)+(1.077)+(2.023), (I-749)+(1.077)+(2.024), (I-749)+(1.077)+(2.025), (I-749)+(1.077)+(2.026), (I-749)+(1.077)+(2.027), (I-749)+(1.077)+(2.028), (I-749)+(1.077)+(2.029), (I-749)+(1.077)+(2.030), (I-749)+(1.077)+(2.031), (I-749)+(1.077)+(2.032), (I-749)+(1.077)+(2.033), (I-749)+(1.077)+(2.034), (I-749)+(1.077)+(2.035), (I-749)+(1.077)+(2.036), (I-749)+(1.077)+(2.037), (I-749)+(1.077)+(2.038), (I-749)+(1.077)+(2.039), (I-749)+(1.077)+(2.040), (I-749)+(1.077)+(2.041), (I-749)+(1.077)+(2.042), (I-749)+(1.077)+(2.043), (I-749)+(1.077)+(2.044), (I-749)+(1.077)+(2.045), (I-749)+(1.077)+(2.046), (I-749)+(1.077)+(2.047), (I-749)+(1.077)+(2.048), (I-749)+(1.077)+(2.049), (I-749)+(1.077)+(2.050), (I-749)+(1.077)+(2.051), (I-749)+(1.077)+(2.052), (I-749)+(1.077)+(2.053), (I-749)+(1.077)+(2.054), (I-749)+(1.077)+(2.055), (I-749)+(1.077)+(2.056), (I-749)+(1.077)+(2.057), (I-749)+(1.077)+(2.058), (I-749)+(1.077)+(2.059), (I-749)+(1.077)+(3.001), (I-749)+(1.077)+(3.002), (I-749)+(1.077)+(3.003), (I-749)+(1.077)+(3.004), (I-749)+(1.077)+(3.005), (I-749)+(1.077)+(3.006), (I-749)+(1.077)+(3.007), (I-749)+(1.077)+(3.008), (I-749)+(1.077)+(3.009), (I-749)+(1.077)+(3.010), (I-749)+(1.077)+(3.011), (I-749)+(1.077)+(3.012), (I-749)+(1.077)+(3.013), (I-749)+(1.077)+(3.014), (I-749)+(1.077)+(3.015), (I-749)+(1.077)+(3.016), (I-749)+(1.077)+(3.017), (I-749)+(1.077)+(3.018), (I-749)+(1.077)+(3.019), (I-749)+(1.077)+(3.020), (I-749)+(1.077)+(3.021), (I-749)+(1.077)+(3.022), (I-749)+(1.077)+(3.023), (I-749)+(1.077)+(3.024), (I-749)+(1.077)+(3.025), (I-749)+(1.077)+(3.026), (I-749)+(1.077)+(3.027), (I-749)+(1.077)+(3.028), (I-749)+(1.077)+(3.029), (I-749)+(1.077)+(3.030), (I-749)+(1.077)+(3.031), (I-749)+(1.077)+(5.001), (I-749)+(1.077)+(5.002), (I-749)+(1.077)+(5.003), (I-749)+(1.077)+(5.004), (I-749)+(1.077)+(5.005), (I-749)+(1.077)+(5.006), (I-749)+(1.077)+(5.007), (I-749)+(1.077)+(5.008), (I-749)+(1.077)+(5.009), (I-749)+(1.077)+(5.010), (I-749)+(1.077)+(5.011), (I-749)+(1.077)+(5.012), (I-749)+(1.077)+(5.013), (I-749)+(1.077)+(5.014), (I-749)+(1.077)+(5.015), (I-749)+(1.077)+(5.016), (I-749)+(1.077)+(5.017), (I-749)+(1.077)+(5.018), (I-749)+(1.077)+(5.019), (I-749)+(1.077)+(5.020), (I-749)+(1.077)+(5.021), (I-749)+(1.077)+(5.022), (I-749)+(1.077)+(5.023), (I-749)+(1.077)+(6.001), (I-749)+(1.077)+(6.002), (I-749)+(1.077)+(6.003), (I-749)+(1.077)+(6.004), (I-749)+(1.077)+(7.001), (I-749)+(1.077)+(7.002), (I-749)+(1.077)+(7.003), (I-749)+(1.077)+(7.004), (I-749)+(1.077)+(7.005), (I-749)+(1.077)+(7.006), (I-749)+(1.077)+(9.001), (I-749)+(1.077)+(9.002), (I-749)+(1.077)+(9.003), (I-749)+(1.077)+(9.004), (I-749)+(1.077)+(9.005), (I-749)+(1.077)+(9.006), (I-749)+(1.077)+(9.007), (I-749)+(1.077)+(9.008), (I-749)+(1.077)+(9.009), (I-749)+(1.077)+(14.001), (I-749)+(1.077)+(14.002), (I-749)+(1.077)+(15.008), (I-749)+(1.077)+(15.011), (I-749)+(1.077)+(15.012), (I-749)+(1.077)+(15.016), (I-749)+(1.077)+(15.025), (I-749)+(1.077)+(15.027), (I-749)+(1.077)+(15.047), (I-749)+(1.077)+(15.063), (I-749)+(1.077)+(15.064), (I-749)+(1.077)+(16.001), (I-749)+(1.077)+(16.002), (I-749)+(1.077)+(16.003), (I-749)+(1.077)+(16.004), (I-749)+(1.077)+(16.005), (I-749)+(1.077)+(16.006), (I-749)+(1.077)+(16.007), (I-749)+(1.077)+(16.008), (I-749)+(1.077)+(17.001), (I-749)+(1.077)+(17.002), (I-749)+(1.077)+(17.003), (I-749)+(1.077)+(17.004), (I-749)+(1.077)+(17.005), (I-749)+(1.077)+(17.006), (I-749)+(1.077)+(17.007), (I-749)+(1.077)+(17.008), (I-749)+(1.077)+(17.009), (I-749)+(1.077)+(17.010), (I-749)+(1.077)+(17.011), (I-749)+(1.077)+(17.012), (I-749)+(1.077)+(18.001),

(I-749)+(1.078)+(1.079), (I-749)+(1.078)+(1.080), (I-749)+(1.078)+(1.081), (I-749)+(1.078)+(1.082), (I-749)+(1.078)+(1.083), (I-749)+(1.078)+(1.084), (I-749)+(1.078)+(1.085), (I-749)+(1.078)+(1.086), (I-749)+(1.078)+(1.087), (I-749)+(1.078)+(1.088), (I-749)+(1.078)+(1.089), (I-749)+(1.078)+(1.090), (I-749)+(1.078)+(1.091), (I-749)+(1.078)+(1.092), (I-749)+(1.078)+(2.001), (I-749)+(1.078)+(2.002), (I-749)+(1.078)+(2.003), (I-749)+(1.078)+(2.004), (I-749)+(1.078)+(2.005), (I-749)+(1.078)+(2.006), (I-749)+(1.078)+(2.007), (I-749)+(1.078)+(2.008), (I-749)+(1.078)+(2.009), (I-749)+(1.078)+(2.010), (I-749)+(1.078)+(2.011), (I-749)+(1.078)+(2.012), (I-749)+(1.078)+(2.013), (I-749)+(1.078)+(2.014), (I-749)+(1.078)+(2.015), (I-749)+(1.078)+(2.016), (I-749)+(1.078)+(2.017), (I-749)+(1.078)+(2.018), (I-749)+(1.078)+(2.019), (I-749)+(1.078)+(2.020), (I-749)+(1.078)+(2.021), (I-749)+(1.078)+(2.022), (I-749)+(1.078)+(2.023), (I-749)+(1.078)+(2.024), (I-749)+(1.078)+(2.025), (I-749)+(1.078)+(2.026), (I-749)+(1.078)+(2.027), (I-749)+(1.078)+(2.028), (I-749)+(1.078)+(2.029), (I-749)+(1.078)+(2.030), (I-749)+(1.078)+(2.031), (I-749)+(1.078)+(2.032), (I-749)+(1.078)+(2.033), (I-749)+(1.078)+(2.034), (I-749)+(1.078)+(2.035), (I-749)+(1.078)+(2.036), (I-749)+(1.078)+(2.037), (I-749)+(1.078)+(2.038), (I-749)+(1.078)+(2.039), (I-749)+(1.078)+(2.040), (I-749)+(1.078)+(2.041), (I-749)+(1.078)+(2.042), (I-749)+(1.078)+(2.043), (I-749)+(1.078)+(2.044), (I-749)+(1.078)+(2.045), (I-749)+(1.078)+(2.046), (I-749)+(1.078)+(2.047), (I-749)+(1.078)+(2.048), (I-749)+(1.078)+(2.049), (I-749)+(1.078)+(2.050), (I-749)+(1.078)+(2.051), (I-749)+(1.078)+(2.052), (I-749)+(1.078)+(2.053), (I-749)+(1.078)+(2.054), (I-749)+(1.078)+(2.055), (I-749)+(1.078)+(2.056), (I-749)+(1.078)+(2.057), (I-749)+(1.078)+(2.058), (I-749)+(1.078)+(2.059), (I-749)+(1.078)+(3.001), (I-749)+(1.078)+(3.002), (I-749)+(1.078)+(3.003), (I-749)+(1.078)+(3.004), (I-749)+(1.078)+(3.005), (I-749)+(1.078)+(3.006), (I-749)+(1.078)+(3.007), (I-749)+(1.078)+(3.008), (I-749)+(1.078)+(3.009), (I-749)+(1.078)+(3.010), (I-749)+(1.078)+(3.011), (I-749)+(1.078)+(3.012), (I-749)+(1.078)+(3.013), (I-749)+(1.078)+(3.014), (I-749)+(1.078)+(3.015), (I-749)+(1.078)+(3.016), (I-749)+(1.078)+(3.017), (I-749)+(1.078)+(3.018), (I-749)+(1.078)+(3.019), (I-749)+(1.078)+(3.020), (I-749)+(1.078)+(3.021), (I-749)+(1.078)+(3.022), (I-749)+(1.078)+(3.023), (I-749)+(1.078)+(3.024), (I-749)+(1.078)+(3.025), (I-749)+(1.078)+(3.026), (I-749)+(1.078)+(3.027), (I-749)+(1.078)+(3.028), (I-749)+(1.078)+(3.029), (I-749)+(1.078)+(3.030), (I-749)+(1.078)+(3.031), (I-749)+(1.078)+(5.001), (I-749)+(1.078)+(5.002), (I-749)+(1.078)+(5.003), (I-749)+(1.078)+(5.004), (I-749)+(1.078)+(5.005), (I-749)+(1.078)+(5.006), (I-749)+(1.078)+(5.007), (I-749)+(1.078)+(5.008), (I-749)+(1.078)+(5.009), (I-749)+(1.078)+(5.010), (I-749)+(1.078)+(5.011), (I-749)+(1.078)+(5.012), (I-749)+(1.078)+(5.013), (I-749)+(1.078)+(5.014), (I-749)+(1.078)+(5.015), (I-749)+(1.078)+(5.016), (I-749)+(1.078)+(5.017), (I-749)+(1.078)+(5.018), (I-749)+(1.078)+(5.019), (I-749)+(1.078)+(5.020), (I-749)+(1.078)+(5.021), (I-749)+(1.078)+(5.022), (I-749)+(1.078)+(5.023), (I-749)+(1.078)+(6.001), (I-749)+(1.078)+(6.002), (I-749)+(1.078)+(6.003), (I-749)+(1.078)+(6.004), (I-749)+(1.078)+(7.001), (I-749)+(1.078)+(7.002), (I-749)+(1.078)+(7.003), (I-749)+(1.078)+(7.004), (I-749)+(1.078)+(7.005), (I-749)+(1.078)+(7.006), (I-749)+(1.078)+(9.001), (I-749)+(1.078)+(9.002), (I-749)+(1.078)+(9.003), (I-749)+(1.078)+(9.004), (I-749)+(1.078)+(9.005), (I-749)+(1.078)+(9.006), (I-749)+(1.078)+(9.007), (I-749)+(1.078)+(9.008), (I-749)+(1.078)+(9.009), (I-749)+(1.078)+(14.001), (I-749)+(1.078)+(14.002), (I-749)+(1.078)+(15.008), (I-749)+(1.078)+(15.011), (I-749)+(1.078)+(15.012), (I-749)+(1.078)+(15.016), (I-749)+(1.078)+(15.025), (I-749)+(1.078)+(15.027), (I-749)+(1.078)+(15.047), (I-749)+(1.078)+(15.063), (I-749)+(1.078)+(15.064), (I-749)+(1.078)+(16.001), (I-749)+(1.078)+(16.002), (I-749)+(1.078)+(16.003), (I-749)+(1.078)+(16.004), (I-749)+(1.078)+(16.005), (I-749)+(1.078)+(16.006), (I-749)+(1.078)+(16.007), (I-749)+(1.078)+(16.008), (I-749)+(1.078)+(17.001), (I-749)+(1.078)+(17.002), (I-749)+(1.078)+(17.003), (I-749)+(1.078)+(17.004), (I-749)+(1.078)+(17.005), (I-749)+(1.078)+(17.006), (I-749)+(1.078)+(17.007), (I-749)+(1.078)+(17.008), (I-749)+(1.078)+(17.009), (I-749)+(1.078)+(17.010), (I-749)+(1.078)+(17.011), (I-749)+(1.078)+(17.012), (I-749)+(1.078)+(18.001),

(I-749)+(1.079)+(1.080), (I-749)+(1.079)+(1.081), (I-749)+(1.079)+(1.082), (I-749)+(1.079)+(1.083), (I-749)+(1.079)+(1.084), (I-749)+(1.079)+(1.085), (I-749)+(1.079)+(1.086), (I-749)+(1.079)+(1.087), (I-749)+(1.079)+(1.088), (I-749)+(1.079)+(1.089), (I-749)+(1.079)+(1.090), (I-749)+(1.079)+(1.091), (I-749)+(1.079)+(1.092), (I-749)+(1.079)+(2.001), (I-749)+(1.079)+(2.002), (I-749)+(1.079)+(2.003), (I-749)+(1.079)+(2.004), (I-749)+(1.079)+(2.005), (I-749)+(1.079)+(2.006), (I-749)+(1.079)+(2.007), (I-749)+(1.079)+(2.008), (I-749)+(1.079)+(2.009), (I-749)+(1.079)+(2.010), (I-749)+(1.079)+(2.011), (I-749)+(1.079)+(2.012), (I-749)+(1.079)+(2.013), (I-749)+(1.079)+(2.014), (I-749)+(1.079)+(2.015), (I-749)+(1.079)+(2.016), (I-749)+(1.079)+(2.017), (I-749)+(1.079)+(2.018), (I-749)+(1.079)+(2.019), (I-749)+(1.079)+(2.020), (I-749)+(1.079)+(2.021), (I-749)+(1.079)+(2.022), (I-749)+(1.079)+(2.023), (I-749)+(1.079)+(2.024), (I-749)+(1.079)+(2.025), (I-749)+(1.079)+(2.026), (I-749)+(1.079)+(2.027), (I-749)+(1.079)+(2.028), (I-749)+(1.079)+(2.029), (I-749)+(1.079)+(2.030), (I-749)+(1.079)+(2.031), (I-749)+(1.079)+(2.032), (I-749)+(1.079)+(2.033), (I-749)+(1.079)+(2.034), (I-749)+(1.079)+(2.035), (I-749)+(1.079)+(2.036), (I-749)+(1.079)+(2.037), (I-749)+(1.079)+(2.038), (I-749)+(1.079)+(2.039), (I-749)+(1.079)+(2.040), (I-749)+(1.079)+(2.041), (I-749)+(1.079)+(2.042), (I-749)+(1.079)+(2.043), (I-749)+(1.079)+(2.044), (I-749)+(1.079)+(2.045), (I-749)+(1.079)+(2.046), (I-749)+(1.079)+(2.047), (I-749)+(1.079)+(2.048), (I-749)+(1.079)+(2.049), (I-749)+(1.079)+(2.050), (I-749)+(1.079)+(2.051), (I-749)+(1.079)+(2.052), (I-749)+(1.079)+(2.053), (I-749)+(1.079)+(2.054), (I-749)+(1.079)+(2.055), (I-749)+(1.079)+(2.056), (I-749)+(1.079)+(2.057), (I-749)+(1.079)+(2.058), (I-749)+(1.079)+(2.059), (I-749)+(1.079)+(3.001), (I-749)+(1.079)+(3.002), (I-749)+(1.079)+(3.003), (I-749)+(1.079)+(3.004), (I-749)+(1.079)+(3.005), (I-749)+(1.079)+(3.006), (I-749)+(1.079)+(3.007), (I-749)+(1.079)+(3.008), (I-749)+(1.079)+(3.009), (I-749)+(1.079)+(3.010), (I-749)+(1.079)+(3.011), (I-749)+(1.079)+(3.012), (I-749)+(1.079)+(3.013), (I-749)+(1.079)+(3.014), (I-749)+(1.079)+(3.015), (I-749)+(1.079)+(3.016), (I-749)+(1.079)+(3.017), (I-749)+(1.079)+(3.018), (I-749)+(1.079)+(3.019), (I-749)+(1.079)+(3.020), (I-749)+(1.079)+(3.021), (I-749)+(1.079)+(3.022), (I-749)+(1.079)+(3.023), (I-749)+(1.079)+(3.024), (I-749)+(1.079)+(3.025), (I-749)+(1.079)+(3.026), (I-749)+(1.079)+(3.027), (I-749)+(1.079)+(3.028), (I-749)+(1.079)+(3.029), (I-749)+(1.079)+(3.030), (I-749)+(1.079)+(3.031), (I-749)+(1.079)+(5.001), (I-749)+(1.079)+(5.002), (I-749)+(1.079)+(5.003), (I-749)+(1.079)+(5.004), (I-749)+(1.079)+(5.005), (I-749)+(1.079)+(5.006), (I-749)+(1.079)+(5.007), (I-749)+(1.079)+(5.008), (I-749)+(1.079)+(5.009), (I-749)+(1.079)+(5.010), (I-749)+(1.079)+(5.011), (I-749)+(1.079)+(5.012), (I-749)+(1.079)+(5.013), (I-749)+(1.079)+(5.014), (I-749)+(1.079)+(5.015), (I-749)+(1.079)+(5.016), (I-749)+(1.079)+(5.017), (I-749)+(1.079)+(5.018), (I-749)+(1.079)+(5.019), (I-749)+(1.079)+(5.020), (I-749)+(1.079)+(5.021), (I-749)+(1.079)+(5.022), (I-749)+(1.079)+(5.023), (I-749)+(1.079)+(6.001), (I-749)+(1.079)+(6.002), (I-749)+(1.079)+(6.003), (I-749)+(1.079)+(6.004), (I-749)+(1.079)+(7.001), (I-749)+(1.079)+(7.002), (I-749)+(1.079)+(7.003), (I-749)+(1.079)+(7.004), (I-749)+(1.079)+(7.005), (I-749)+(1.079)+(7.006), (I-749)+(1.079)+(9.001), (I-749)+(1.079)+(9.002), (I-749)+(1.079)+(9.003), (I-749)+(1.079)+(9.004), (I-749)+(1.079)+(9.005), (I-749)+(1.079)+(9.006), (I-749)+(1.079)+(9.007), (I-749)+(1.079)+(9.008), (I-749)+(1.079)+(9.009), (I-749)+(1.079)+(14.001), (I-749)+(1.079)+(14.002), (I-749)+(1.079)+(15.008), (I-749)+(1.079)+(15.011), (I-749)+(1.079)+(15.012), (I-749)+(1.079)+(15.016), (I-749)+(1.079)+(15.025), (I-749)+(1.079)+(15.027), (I-749)+(1.079)+(15.047), (I-749)+(1.079)+(15.063), (I-749)+(1.079)+(15.064), (I-749)+(1.079)+(16.001), (I-749)+(1.079)+(16.002), (I-749)+(1.079)+(16.003), (I-749)+(1.079)+(16.004), (I-749)+(1.079)+(16.005), (I-749)+(1.079)+(16.006), (I-749)+(1.079)+(16.007), (I-749)+(1.079)+(16.008), (I-749)+(1.079)+(17.001), (I-749)+(1.079)+(17.002), (I-749)+(1.079)+(17.003), (I-749)+(1.079)+(17.004), (I-749)+(1.079)+(17.005), (I-749)+(1.079)+(17.006), (I-749)+(1.079)+(17.007), (I-749)+(1.079)+(17.008), (I-749)+(1.079)+(17.009), (I-749)+(1.079)+(17.010), (I-749)+(1.079)+(17.011), (I-749)+(1.079)+(17.012), (I-749)+(1.079)+(18.001),

(I-749)+(1.080)+(1.081), (I-749)+(1.080)+(1.082), (I-749)+(1.080)+(1.083), (I-749)+(1.080)+(1.084), (I-749)+(1.080)+(1.085), (I-749)+(1.080)+(1.086), (I-749)+(1.080)+(1.087), (I-749)+(1.080)+(1.088), (I-749)+(1.080)+(1.089), (I-749)+(1.080)+(1.090), (I-749)+(1.080)+(1.091), (I-749)+(1.080)+(1.092), (I-749)+(1.080)+(2.001), (I-749)+(1.080)+(2.002), (I-749)+(1.080)+(2.003), (I-749)+(1.080)+(2.004), (I-749)+(1.080)+(2.005), (I-749)+(1.080)+(2.006), (I-749)+(1.080)+(2.007), (I-749)+(1.080)+(2.008), (I-749)+(1.080)+(2.009), (I-749)+(1.080)+(2.010), (I-749)+(1.080)+(2.011), (I-749)+(1.080)+(2.012), (I-749)+(1.080)+(2.013), (I-749)+(1.080)+(2.014), (I-749)+(1.080)+(2.015), (I-749)+(1.080)+(2.016), (I-749)+(1.080)+(2.017), (I-749)+(1.080)+(2.018), (I-749)+(1.080)+(2.019), (I-749)+(1.080)+(2.020), (I-749)+(1.080)+(2.021), (I-749)+(1.080)+(2.022), (I-749)+(1.080)+(2.023), (I-749)+(1.080)+(2.024), (I-749)+(1.080)+(2.025), (I-749)+(1.080)+(2.026), (I-749)+(1.080)+(2.027), (I-749)+(1.080)+(2.028), (I-749)+(1.080)+(2.029), (I-749)+(1.080)+(2.030), (I-749)+(1.080)+(2.031), (I-749)+(1.080)+(2.032), (I-749)+(1.080)+(2.033), (I-749)+(1.080)+(2.034), (I-749)+(1.080)+(2.035), (I-749)+(1.080)+(2.036), (I-749)+(1.080)+(2.037), (I-749)+(1.080)+(2.038), (I-749)+(1.080)+(2.039), (I-749)+(1.080)+(2.040), (I-749)+(1.080)+(2.041), (I-749)+(1.080)+(2.042), (I-749)+(1.080)+(2.043), (I-749)+(1.080)+(2.044), (I-749)+(1.080)+(2.045), (I-749)+(1.080)+(2.046), (I-749)+(1.080)+(2.047), (I-749)+(1.080)+(2.048), (I-749)+(1.080)+(2.049), (I-749)+(1.080)+(2.050), (I-749)+(1.080)+(2.051), (I-749)+(1.080)+(2.052), (I-749)+(1.080)+(2.053), (I-749)+(1.080)+(2.054), (I-749)+(1.080)+(2.055), (I-749)+(1.080)+(2.056), (I-749)+(1.080)+(2.057), (I-749)+(1.080)+(2.058), (I-749)+(1.080)+(2.059), (I-749)+(1.080)+(3.001), (I-749)+(1.080)+(3.002), (I-749)+(1.080)+(3.003), (I-749)+(1.080)+(3.004), (I-749)+(1.080)+(3.005), (I-749)+(1.080)+(3.006), (I-749)+(1.080)+(3.007), (I-749)+(1.080)+(3.008), (I-749)+(1.080)+(3.009), (I-749)+(1.080)+(3.010), (I-749)+(1.080)+(3.011), (I-749)+(1.080)+(3.012), (I-749)+(1.080)+(3.013), (I-749)+(1.080)+(3.014), (I-749)+(1.080)+(3.015), (I-749)+(1.080)+(3.016), (I-749)+(1.080)+(3.017), (I-749)+(1.080)+(3.018), (I-749)+(1.080)+(3.019), (I-749)+(1.080)+(3.020), (I-749)+(1.080)+(3.021), (I-749)+(1.080)+(3.022), (I-749)+(1.080)+(3.023), (I-749)+(1.080)+(3.024), (I-749)+(1.080)+(3.025), (I-749)+(1.080)+(3.026), (I-749)+(1.080)+(3.027), (I-749)+(1.080)+(3.028), (I-749)+(1.080)+(3.029), (I-749)+(1.080)+(3.030), (I-749)+(1.080)+(3.031), (I-749)+(1.080)+(5.001), (I-749)+(1.080)+(5.002), (I-749)+(1.080)+(5.003), (I-749)+(1.080)+(5.004), (I-749)+(1.080)+(5.005), (I-749)+(1.080)+(5.006), (I-749)+(1.080)+(5.007), (I-749)+(1.080)+(5.008), (I-749)+(1.080)+(5.009), (I-749)+(1.080)+(5.010), (I-749)+(1.080)+(5.011), (I-749)+(1.080)+(5.012), (I-749)+(1.080)+(5.013), (I-749)+(1.080)+(5.014), (I-749)+(1.080)+(5.015), (I-749)+(1.080)+(5.016), (I-749)+(1.080)+(5.017), (I-749)+(1.080)+(5.018), (I-749)+(1.080)+(5.019), (I-749)+(1.080)+(5.020), (I-749)+(1.080)+(5.021), (I-749)+(1.080)+(5.022), (I-749)+(1.080)+(5.023), (I-749)+(1.080)+(6.001), (I-749)+(1.080)+(6.002), (I-749)+(1.080)+(6.003), (I-749)+(1.080)+(6.004), (I-749)+(1.080)+(7.001), (I-749)+(1.080)+(7.002), (I-749)+(1.080)+(7.003), (I-749)+(1.080)+(7.004), (I-749)+(1.080)+(7.005), (I-749)+(1.080)+(7.006), (I-749)+(1.080)+(9.001), (I-749)+(1.080)+(9.002), (I-749)+(1.080)+(9.003), (I-749)+(1.080)+(9.004), (I-749)+(1.080)+(9.005), (I-749)+(1.080)+(9.006), (I-749)+(1.080)+(9.007), (I-749)+(1.080)+(9.008), (I-749)+(1.080)+(9.009), (I-749)+(1.080)+(14.001), (I-749)+(1.080)+(14.002), (I-749)+(1.080)+(15.008), (I-749)+(1.080)+(15.011), (I-749)+(1.080)+(15.012), (I-749)+(1.080)+(15.016), (I-749)+(1.080)+(15.025), (I-749)+(1.080)+(15.027), (I-749)+(1.080)+(15.047), (I-749)+(1.080)+(15.063), (I-749)+(1.080)+(15.064), (I-749)+(1.080)+(16.001), (I-749)+(1.080)+(16.002), (I-749)+(1.080)+(16.003), (I-749)+(1.080)+(16.004), (I-749)+(1.080)+(16.005), (I-749)+(1.080)+(16.006), (I-749)+(1.080)+(16.007), (I-749)+(1.080)+(16.008), (I-749)+(1.080)+(17.001), (I-749)+(1.080)+(17.002), (I-749)+(1.080)+(17.003), (I-749)+(1.080)+(17.004), (I-749)+(1.080)+(17.005), (I-749)+(1.080)+(17.006), (I-749)+(1.080)+(17.007), (I-749)+(1.080)+(17.008), (I-749)+(1.080)+(17.009), (I-749)+(1.080)+(17.010), (I-749)+(1.080)+(17.011), (I-749)+(1.080)+(17.012), (I-749)+(1.080)+(18.001),

(I-749)+(1.081)+(1.082), (I-749)+(1.081)+(1.083), (I-749)+(1.081)+(1.084), (I-749)+(1.081)+(1.085), (I-749)+(1.081)+(1.086), (I-749)+(1.081)+(1.087), (I-749)+(1.081)+(1.088), (I-749)+(1.081)+(1.089), (I-749)+(1.081)+(1.090), (I-749)+(1.081)+(1.091), (I-749)+(1.081)+(1.092), (I-749)+(1.081)+(2.001), (I-749)+(1.081)+(2.002), (I-749)+(1.081)+(2.003), (I-749)+(1.081)+(2.004), (I-749)+(1.081)+(2.005), (I-749)+(1.081)+(2.006), (I-749)+(1.081)+(2.007), (I-749)+(1.081)+(2.008), (I-749)+(1.081)+(2.009), (I-749)+(1.081)+(2.010), (I-749)+(1.081)+(2.011), (I-749)+(1.081)+(2.012), (I-749)+(1.081)+(2.013), (I-749)+(1.081)+(2.014), (I-749)+(1.081)+(2.015), (I-749)+(1.081)+(2.016), (I-749)+(1.081)+(2.017), (I-749)+(1.081)+(2.018), (I-749)+(1.081)+(2.019), (I-749)+(1.081)+(2.020), (I-749)+(1.081)+(2.021), (I-749)+(1.081)+(2.022), (I-749)+(1.081)+(2.023), (I-749)+(1.081)+(2.024), (I-749)+(1.081)+(2.025), (I-749)+(1.081)+(2.026), (I-749)+(1.081)+(2.027), (I-749)+(1.081)+(2.028), (I-749)+(1.081)+(2.029), (I-749)+(1.081)+(2.030), (I-749)+(1.081)+(2.031), (I-749)+(1.081)+(2.032), (I-749)+(1.081)+(2.033), (I-749)+(1.081)+(2.034), (I-749)+(1.081)+(2.035), (I-749)+(1.081)+(2.036), (I-749)+(1.081)+(2.037), (I-749)+(1.081)+(2.038), (I-749)+(1.081)+(2.039), (I-749)+(1.081)+(2.040), (I-749)+(1.081)+(2.041), (I-749)+(1.081)+(2.042), (I-749)+(1.081)+(2.043), (I-749)+(1.081)+(2.044), (I-749)+(1.081)+(2.045), (I-749)+(1.081)+(2.046), (I-749)+(1.081)+(2.047), (I-749)+(1.081)+(2.048), (I-749)+(1.081)+(2.049), (I-749)+(1.081)+(2.050), (I-749)+(1.081)+(2.051), (I-749)+(1.081)+(2.052), (I-749)+(1.081)+(2.053), (I-749)+(1.081)+(2.054), (I-749)+(1.081)+(2.055), (I-749)+(1.081)+(2.056), (I-749)+(1.081)+(2.057), (I-749)+(1.081)+(2.058), (I-749)+(1.081)+(2.059), (I-749)+(1.081)+(3.001), (I-749)+(1.081)+(3.002), (I-749)+(1.081)+(3.003), (I-749)+(1.081)+(3.004), (I-749)+(1.081)+(3.005), (I-749)+(1.081)+(3.006), (I-749)+(1.081)+(3.007), (I-749)+(1.081)+(3.008), (I-749)+(1.081)+(3.009), (I-749)+(1.081)+(3.010), (I-749)+(1.081)+(3.011), (I-749)+(1.081)+(3.012), (I-749)+(1.081)+(3.013), (I-749)+(1.081)+(3.014), (I-749)+(1.081)+(3.015), (I-749)+(1.081)+(3.016), (I-749)+(1.081)+(3.017), (I-749)+(1.081)+(3.018), (I-749)+(1.081)+(3.019), (I-749)+(1.081)+(3.020), (I-749)+(1.081)+(3.021), (I-749)+(1.081)+(3.022), (I-749)+(1.081)+(3.023), (I-749)+(1.081)+(3.024), (I-749)+(1.081)+(3.025), (I-749)+(1.081)+(3.026), (I-749)+(1.081)+(3.027), (I-749)+(1.081)+(3.028), (I-749)+(1.081)+(3.029), (I-749)+(1.081)+(3.030), (I-749)+(1.081)+(3.031), (I-749)+(1.081)+(5.001), (I-749)+(1.081)+(5.002), (I-749)+(1.081)+(5.003), (I-749)+(1.081)+(5.004), (I-749)+(1.081)+(5.005), (I-749)+(1.081)+(5.006), (I-749)+(1.081)+(5.007), (I-749)+(1.081)+(5.008), (I-749)+(1.081)+(5.009), (I-749)+(1.081)+(5.010), (I-749)+(1.081)+(5.011), (I-749)+(1.081)+(5.012), (I-749)+(1.081)+(5.013), (I-749)+(1.081)+(5.014), (I-749)+(1.081)+(5.015), (I-749)+(1.081)+(5.016), (I-749)+(1.081)+(5.017), (I-749)+(1.081)+(5.018), (I-749)+(1.081)+(5.019), (I-749)+(1.081)+(5.020), (I-749)+(1.081)+(5.021), (I-749)+(1.081)+(5.022), (I-749)+(1.081)+(5.023), (I-749)+(1.081)+(6.001), (I-749)+(1.081)+(6.002), (I-749)+(1.081)+(6.003), (I-749)+(1.081)+(6.004), (I-749)+(1.081)+(7.001), (I-749)+(1.081)+(7.002), (I-749)+(1.081)+(7.003), (I-749)+(1.081)+(7.004), (I-749)+(1.081)+(7.005), (I-749)+(1.081)+(7.006), (I-749)+(1.081)+(9.001), (I-749)+(1.081)+(9.002), (I-749)+(1.081)+(9.003), (I-749)+(1.081)+(9.004), (I-749)+(1.081)+(9.005), (I-749)+(1.081)+(9.006), (I-749)+(1.081)+(9.007), (I-749)+(1.081)+(9.008), (I-749)+(1.081)+(9.009), (I-749)+(1.081)+(14.001), (I-749)+(1.081)+(14.002), (I-749)+(1.081)+(15.008), (I-749)+(1.081)+(15.011), (I-749)+(1.081)+(15.012), (I-749)+(1.081)+(15.016), (I-749)+(1.081)+(15.025), (I-749)+(1.081)+(15.027), (I-749)+(1.081)+(15.047), (I-749)+(1.081)+(15.063), (I-749)+(1.081)+(15.064), (I-749)+(1.081)+(16.001), (I-749)+(1.081)+(16.002), (I-749)+(1.081)+(16.003), (I-749)+(1.081)+(16.004), (I-749)+(1.081)+(16.005), (I-749)+(1.081)+(16.006), (I-749)+(1.081)+(16.007), (I-749)+(1.081)+(16.008), (I-749)+(1.081)+(17.001), (I-749)+(1.081)+(17.002), (I-749)+(1.081)+(17.003), (I-749)+(1.081)+(17.004), (I-749)+(1.081)+(17.005), (I-749)+(1.081)+(17.006), (I-749)+(1.081)+(17.007), (I-749)+(1.081)+(17.008), (I-749)+(1.081)+(17.009), (I-749)+(1.081)+(17.010), (I-749)+(1.081)+(17.011), (I-749)+(1.081)+(17.012), (I-749)+(1.081)+(18.001),

(I-749)+(1.082)+(1.083), (I-749)+(1.082)+(1.084), (I-749)+(1.082)+(1.085), (I-749)+(1.082)+(1.086), (I-749)+(1.082)+(1.087), (I-749)+(1.082)+(1.088), (I-749)+(1.082)+(1.089), (I-749)+(1.082)+(1.090), (I-749)+(1.082)+(1.091), (I-749)+(1.082)+(1.092), (I-749)+(1.082)+(2.001), (I-749)+(1.082)+(2.002), (I-749)+(1.082)+(2.003), (I-749)+(1.082)+(2.004), (I-749)+(1.082)+(2.005), (I-749)+(1.082)+(2.006), (I-749)+(1.082)+(2.007), (I-749)+(1.082)+(2.008), (I-749)+(1.082)+(2.009), (I-749)+(1.082)+(2.010), (I-749)+(1.082)+(2.011), (I-749)+(1.082)+(2.012), (I-749)+(1.082)+(2.013), (I-749)+(1.082)+(2.014), (I-749)+(1.082)+(2.015), (I-749)+(1.082)+(2.016), (I-749)+(1.082)+(2.017), (I-749)+(1.082)+(2.018), (I-749)+(1.082)+(2.019), (I-749)+(1.082)+(2.020), (I-749)+(1.082)+(2.021), (I-749)+(1.082)+(2.022), (I-749)+(1.082)+(2.023), (I-749)+(1.082)+(2.024), (I-749)+(1.082)+(2.025), (I-749)+(1.082)+(2.026), (I-749)+(1.082)+(2.027), (I-749)+(1.082)+(2.028), (I-749)+(1.082)+(2.029), (I-749)+(1.082)+(2.030), (I-749)+(1.082)+(2.031), (I-749)+(1.082)+(2.032), (I-749)+(1.082)+(2.033), (I-749)+(1.082)+(2.034), (I-749)+(1.082)+(2.035), (I-749)+(1.082)+(2.036), (I-749)+(1.082)+(2.037), (I-749)+(1.082)+(2.038), (I-749)+(1.082)+(2.039), (I-749)+(1.082)+(2.040), (I-749)+(1.082)+(2.041), (I-749)+(1.082)+(2.042), (I-749)+(1.082)+(2.043), (I-749)+(1.082)+(2.044), (I-749)+(1.082)+(2.045), (I-749)+(1.082)+(2.046), (I-749)+(1.082)+(2.047), (I-749)+(1.082)+(2.048), (I-749)+(1.082)+(2.049), (I-749)+(1.082)+(2.050), (I-749)+(1.082)+(2.051), (I-749)+(1.082)+(2.052), (I-749)+(1.082)+(2.053), (I-749)+(1.082)+(2.054), (I-749)+(1.082)+(2.055), (I-749)+(1.082)+(2.056), (I-749)+(1.082)+(2.057), (I-749)+(1.082)+(2.058), (I-749)+(1.082)+(2.059), (I-749)+(1.082)+(3.001), (I-749)+(1.082)+(3.002), (I-749)+(1.082)+(3.003), (I-749)+(1.082)+(3.004), (I-749)+(1.082)+(3.005), (I-749)+(1.082)+(3.006), (I-749)+(1.082)+(3.007), (I-749)+(1.082)+(3.008), (I-749)+(1.082)+(3.009), (I-749)+(1.082)+(3.010), (I-749)+(1.082)+(3.011), (I-749)+(1.082)+(3.012), (I-749)+(1.082)+(3.013), (I-749)+(1.082)+(3.014), (I-749)+(1.082)+(3.015), (I-749)+(1.082)+(3.016), (I-749)+(1.082)+(3.017), (I-749)+(1.082)+(3.018), (I-749)+(1.082)+(3.019), (I-749)+(1.082)+(3.020), (I-749)+(1.082)+(3.021), (I-749)+(1.082)+(3.022), (I-749)+(1.082)+(3.023), (I-749)+(1.082)+(3.024), (I-749)+(1.082)+(3.025), (I-749)+(1.082)+(3.026), (I-749)+(1.082)+(3.027), (I-749)+(1.082)+(3.028), (I-749)+(1.082)+(3.029), (I-749)+(1.082)+(3.030), (I-749)+(1.082)+(3.031), (I-749)+(1.082)+(5.001), (I-749)+(1.082)+(5.002), (I-749)+(1.082)+(5.003), (I-749)+(1.082)+(5.004), (I-749)+(1.082)+(5.005), (I-749)+(1.082)+(5.006), (I-749)+(1.082)+(5.007), (I-749)+(1.082)+(5.008), (I-749)+(1.082)+(5.009), (I-749)+(1.082)+(5.010), (I-749)+(1.082)+(5.011), (I-749)+(1.082)+(5.012), (I-749)+(1.082)+(5.013), (I-749)+(1.082)+(5.014), (I-749)+(1.082)+(5.015), (I-749)+(1.082)+(5.016), (I-749)+(1.082)+(5.017), (I-749)+(1.082)+(5.018), (I-749)+(1.082)+(5.019), (I-749)+(1.082)+(5.020), (I-749)+(1.082)+(5.021), (I-749)+(1.082)+(5.022), (I-749)+(1.082)+(5.023), (I-749)+(1.082)+(6.001), (I-749)+(1.082)+(6.002), (I-749)+(1.082)+(6.003), (I-749)+(1.082)+(6.004), (I-749)+(1.082)+(7.001), (I-749)+(1.082)+(7.002), (I-749)+(1.082)+(7.003), (I-749)+(1.082)+(7.004), (I-749)+(1.082)+(7.005), (I-749)+(1.082)+(7.006), (I-749)+(1.082)+(9.001), (I-749)+(1.082)+(9.002), (I-749)+(1.082)+(9.003), (I-749)+(1.082)+(9.004), (I-749)+(1.082)+(9.005), (I-749)+(1.082)+(9.006), (I-749)+(1.082)+(9.007), (I-749)+(1.082)+(9.008), (I-749)+(1.082)+(9.009), (I-749)+(1.082)+(14.001), (I-749)+(1.082)+(14.002), (I-749)+(1.082)+(15.008), (I-749)+(1.082)+(15.011), (I-749)+(1.082)+(15.012), (I-749)+(1.082)+(15.016), (I-749)+(1.082)+(15.025), (I-749)+(1.082)+(15.027), (I-749)+(1.082)+(15.047), (I-749)+(1.082)+(15.063), (I-749)+(1.082)+(15.064), (I-749)+(1.082)+(16.001), (I-749)+(1.082)+(16.002), (I-749)+(1.082)+(16.003), (I-749)+(1.082)+(16.004), (I-749)+(1.082)+(16.005), (I-749)+(1.082)+(16.006), (I-749)+(1.082)+(16.007), (I-749)+(1.082)+(16.008), (I-749)+(1.082)+(17.001), (I-749)+(1.082)+(17.002), (I-749)+(1.082)+(17.003), (I-749)+(1.082)+(17.004), (I-749)+(1.082)+(17.005), (I-749)+(1.082)+(17.006), (I-749)+(1.082)+(17.007), (I-749)+(1.082)+(17.008), (I-749)+(1.082)+(17.009), (I-749)+(1.082)+(17.010), (I-749)+(1.082)+(17.011), (I-749)+(1.082)+(17.012), (I-749)+(1.082)+(18.001),

(I-749)+(1.083)+(1.084), (I-749)+(1.083)+(1.085), (I-749)+(1.083)+(1.086), (I-749)+(1.083)+(1.087), (I-749)+(1.083)+(1.088), (I-749)+(1.083)+(1.089), (I-749)+(1.083)+(1.090), (I-749)+(1.083)+(1.091), (I-749)+(1.083)+(1.092), (I-749)+(1.083)+(2.001), (I-749)+(1.083)+(2.002), (I-749)+(1.083)+(2.003), (I-749)+(1.083)+(2.004), (I-749)+(1.083)+(2.005), (I-749)+(1.083)+(2.006), (I-749)+(1.083)+(2.007), (I-749)+(1.083)+(2.008), (I-749)+(1.083)+(2.009), (I-749)+(1.083)+(2.010), (I-749)+(1.083)+(2.011), (I-749)+(1.083)+(2.012), (I-749)+(1.083)+(2.013), (I-749)+(1.083)+(2.014), (I-749)+(1.083)+(2.015), (I-749)+(1.083)+(2.016), (I-749)+(1.083)+(2.017), (I-749)+(1.083)+(2.018), (I-749)+(1.083)+(2.019), (I-749)+(1.083)+(2.020), (I-749)+(1.083)+(2.021), (I-749)+(1.083)+(2.022), (I-749)+(1.083)+(2.023), (I-749)+(1.083)+(2.024), (I-749)+(1.083)+(2.025), (I-749)+(1.083)+(2.026), (I-749)+(1.083)+(2.027), (I-749)+(1.083)+(2.028), (I-749)+(1.083)+(2.029), (I-749)+(1.083)+(2.030), (I-749)+(1.083)+(2.031), (I-749)+(1.083)+(2.032), (I-749)+(1.083)+(2.033), (I-749)+(1.083)+(2.034), (I-749)+(1.083)+(2.035), (I-749)+(1.083)+(2.036), (I-749)+(1.083)+(2.037), (I-749)+(1.083)+(2.038), (I-749)+(1.083)+(2.039), (I-749)+(1.083)+(2.040), (I-749)+(1.083)+(2.041), (I-749)+(1.083)+(2.042), (I-749)+(1.083)+(2.043), (I-749)+(1.083)+(2.044), (I-749)+(1.083)+(2.045), (I-749)+(1.083)+(2.046), (I-749)+(1.083)+(2.047), (I-749)+(1.083)+(2.048), (I-749)+(1.083)+(2.049), (I-749)+(1.083)+(2.050), (I-749)+(1.083)+(2.051), (I-749)+(1.083)+(2.052), (I-749)+(1.083)+(2.053), (I-749)+(1.083)+(2.054), (I-749)+(1.083)+(2.055), (I-749)+(1.083)+(2.056), (I-749)+(1.083)+(2.057), (I-749)+(1.083)+(2.058), (I-749)+(1.083)+(2.059), (I-749)+(1.083)+(3.001), (I-749)+(1.083)+(3.002), (I-749)+(1.083)+(3.003), (I-749)+(1.083)+(3.004), (I-749)+(1.083)+(3.005), (I-749)+(1.083)+(3.006), (I-749)+(1.083)+(3.007), (I-749)+(1.083)+(3.008), (I-749)+(1.083)+(3.009), (I-749)+(1.083)+(3.010), (I-749)+(1.083)+(3.011), (I-749)+(1.083)+(3.012), (I-749)+(1.083)+(3.013), (I-749)+(1.083)+(3.014), (I-749)+(1.083)+(3.015), (I-749)+(1.083)+(3.016), (I-749)+(1.083)+(3.017), (I-749)+(1.083)+(3.018), (I-749)+(1.083)+(3.019), (I-749)+(1.083)+(3.020), (I-749)+(1.083)+(3.021), (I-749)+(1.083)+(3.022), (I-749)+(1.083)+(3.023), (I-749)+(1.083)+(3.024), (I-749)+(1.083)+(3.025), (I-749)+(1.083)+(3.026), (I-749)+(1.083)+(3.027), (I-749)+(1.083)+(3.028), (I-749)+(1.083)+(3.029), (I-749)+(1.083)+(3.030), (I-749)+(1.083)+(3.031), (I-749)+(1.083)+(5.001), (I-749)+(1.083)+(5.002), (I-749)+(1.083)+(5.003), (I-749)+(1.083)+(5.004), (I-749)+(1.083)+(5.005), (I-749)+(1.083)+(5.006), (I-749)+(1.083)+(5.007), (I-749)+(1.083)+(5.008), (I-749)+(1.083)+(5.009), (I-749)+(1.083)+(5.010), (I-749)+(1.083)+(5.011), (I-749)+(1.083)+(5.012), (I-749)+(1.083)+(5.013), (I-749)+(1.083)+(5.014), (I-749)+(1.083)+(5.015), (I-749)+(1.083)+(5.016), (I-749)+(1.083)+(5.017), (I-749)+(1.083)+(5.018), (I-749)+(1.083)+(5.019), (I-749)+(1.083)+(5.020), (I-749)+(1.083)+(5.021), (I-749)+(1.083)+(5.022), (I-749)+(1.083)+(5.023), (I-749)+(1.083)+(6.001), (I-749)+(1.083)+(6.002), (I-749)+(1.083)+(6.003), (I-749)+(1.083)+(6.004), (I-749)+(1.083)+(7.001), (I-749)+(1.083)+(7.002), (I-749)+(1.083)+(7.003), (I-749)+(1.083)+(7.004), (I-749)+(1.083)+(7.005), (I-749)+(1.083)+(7.006), (I-749)+(1.083)+(9.001), (I-749)+(1.083)+(9.002), (I-749)+(1.083)+(9.003), (I-749)+(1.083)+(9.004), (I-749)+(1.083)+(9.005), (I-749)+(1.083)+(9.006), (I-749)+(1.083)+(9.007), (I-749)+(1.083)+(9.008), (I-749)+(1.083)+(9.009), (I-749)+(1.083)+(14.001), (I-749)+(1.083)+(14.002), (I-749)+(1.083)+(15.008), (I-749)+(1.083)+(15.011), (I-749)+(1.083)+(15.012), (I-749)+(1.083)+(15.016), (I-749)+(1.083)+(15.025), (I-749)+(1.083)+(15.027), (I-749)+(1.083)+(15.047), (I-749)+(1.083)+(15.063), (I-749)+(1.083)+(15.064), (I-749)+(1.083)+(16.001), (I-749)+(1.083)+(16.002), (I-749)+(1.083)+(16.003), (I-749)+(1.083)+(16.004), (I-749)+(1.083)+(16.005), (I-749)+(1.083)+(16.006), (I-749)+(1.083)+(16.007), (I-749)+(1.083)+(16.008), (I-749)+(1.083)+(17.001), (I-749)+(1.083)+(17.002), (I-749)+(1.083)+(17.003), (I-749)+(1.083)+(17.004), (I-749)+(1.083)+(17.005), (I-749)+(1.083)+(17.006), (I-749)+(1.083)+(17.007), (I-749)+(1.083)+(17.008), (I-749)+(1.083)+(17.009), (I-749)+(1.083)+(17.010), (I-749)+(1.083)+(17.011), (I-749)+(1.083)+(17.012), (I-749)+(1.083)+(18.001),

(I-749)+(1.084)+(1.085), (I-749)+(1.084)+(1.086), (I-749)+(1.084)+(1.087), (I-749)+(1.084)+(1.088), (I-749)+(1.084)+(1.089), (I-749)+(1.084)+(1.090), (I-749)+(1.084)+(1.091), (I-749)+(1.084)+(1.092), (I-749)+(1.084)+(2.001), (I-749)+(1.084)+(2.002), (I-749)+(1.084)+(2.003), (I-749)+(1.084)+(2.004), (I-749)+(1.084)+(2.005), (I-749)+(1.084)+(2.006), (I-749)+(1.084)+(2.007), (I-749)+(1.084)+(2.008), (I-749)+(1.084)+(2.009), (I-749)+(1.084)+(2.010), (I-749)+(1.084)+(2.011), (I-749)+(1.084)+(2.012), (I-749)+(1.084)+(2.013), (I-749)+(1.084)+(2.014), (I-749)+(1.084)+(2.015), (I-749)+(1.084)+(2.016), (I-749)+(1.084)+(2.017), (I-749)+(1.084)+(2.018), (I-749)+(1.084)+(2.019), (I-749)+(1.084)+(2.020), (I-749)+(1.084)+(2.021), (I-749)+(1.084)+(2.022), (I-749)+(1.084)+(2.023), (I-749)+(1.084)+(2.024), (I-749)+(1.084)+(2.025), (I-749)+(1.084)+(2.026), (I-749)+(1.084)+(2.027), (I-749)+(1.084)+(2.028), (I-749)+(1.084)+(2.029), (I-749)+(1.084)+(2.030), (I-749)+(1.084)+(2.031), (I-749)+(1.084)+(2.032), (I-749)+(1.084)+(2.033), (I-749)+(1.084)+(2.034), (I-749)+(1.084)+(2.035), (I-749)+(1.084)+(2.036), (I-749)+(1.084)+(2.037), (I-749)+(1.084)+(2.038), (I-749)+(1.084)+(2.039), (I-749)+(1.084)+(2.040), (I-749)+(1.084)+(2.041), (I-749)+(1.084)+(2.042), (I-749)+(1.084)+(2.043), (I-749)+(1.084)+(2.044), (I-749)+(1.084)+(2.045), (I-749)+(1.084)+(2.046), (I-749)+(1.084)+(2.047), (I-749)+(1.084)+(2.048), (I-749)+(1.084)+(2.049), (I-749)+(1.084)+(2.050), (I-749)+(1.084)+(2.051), (I-749)+(1.084)+(2.052), (I-749)+(1.084)+(2.053), (I-749)+(1.084)+(2.054), (I-749)+(1.084)+(2.055), (I-749)+(1.084)+(2.056), (I-749)+(1.084)+(2.057), (I-749)+(1.084)+(2.058), (I-749)+(1.084)+(2.059), (I-749)+(1.084)+(3.001), (I-749)+(1.084)+(3.002), (I-749)+(1.084)+(3.003), (I-749)+(1.084)+(3.004), (I-749)+(1.084)+(3.005), (I-749)+(1.084)+(3.006), (I-749)+(1.084)+(3.007), (I-749)+(1.084)+(3.008), (I-749)+(1.084)+(3.009), (I-749)+(1.084)+(3.010), (I-749)+(1.084)+(3.011), (I-749)+(1.084)+(3.012), (I-749)+(1.084)+(3.013), (I-749)+(1.084)+(3.014), (I-749)+(1.084)+(3.015), (I-749)+(1.084)+(3.016), (I-749)+(1.084)+(3.017), (I-749)+(1.084)+(3.018), (I-749)+(1.084)+(3.019), (I-749)+(1.084)+(3.020), (I-749)+(1.084)+(3.021), (I-749)+(1.084)+(3.022), (I-749)+(1.084)+(3.023), (I-749)+(1.084)+(3.024), (I-749)+(1.084)+(3.025), (I-749)+(1.084)+(3.026), (I-749)+(1.084)+(3.027), (I-749)+(1.084)+(3.028), (I-749)+(1.084)+(3.029), (I-749)+(1.084)+(3.030), (I-749)+(1.084)+(3.031), (I-749)+(1.084)+(5.001), (I-749)+(1.084)+(5.002), (I-749)+(1.084)+(5.003), (I-749)+(1.084)+(5.004), (I-749)+(1.084)+(5.005), (I-749)+(1.084)+(5.006), (I-749)+(1.084)+(5.007), (I-749)+(1.084)+(5.008), (I-749)+(1.084)+(5.009), (I-749)+(1.084)+(5.010), (I-749)+(1.084)+(5.011), (I-749)+(1.084)+(5.012), (I-749)+(1.084)+(5.013), (I-749)+(1.084)+(5.014), (I-749)+(1.084)+(5.015), (I-749)+(1.084)+(5.016), (I-749)+(1.084)+(5.017), (I-749)+(1.084)+(5.018), (I-749)+(1.084)+(5.019), (I-749)+(1.084)+(5.020), (I-749)+(1.084)+(5.021), (I-749)+(1.084)+(5.022), (I-749)+(1.084)+(5.023), (I-749)+(1.084)+(6.001), (I-749)+(1.084)+(6.002), (I-749)+(1.084)+(6.003), (I-749)+(1.084)+(6.004), (I-749)+(1.084)+(7.001), (I-749)+(1.084)+(7.002), (I-749)+(1.084)+(7.003), (I-749)+(1.084)+(7.004), (I-749)+(1.084)+(7.005), (I-749)+(1.084)+(7.006), (I-749)+(1.084)+(9.001), (I-749)+(1.084)+(9.002), (I-749)+(1.084)+(9.003), (I-749)+(1.084)+(9.004), (I-749)+(1.084)+(9.005), (I-749)+(1.084)+(9.006), (I-749)+(1.084)+(9.007), (I-749)+(1.084)+(9.008), (I-749)+(1.084)+(9.009), (I-749)+(1.084)+(14.001), (I-749)+(1.084)+(14.002), (I-749)+(1.084)+(15.008), (I-749)+(1.084)+(15.011), (I-749)+(1.084)+(15.012), (I-749)+(1.084)+(15.016), (I-749)+(1.084)+(15.025), (I-749)+(1.084)+(15.027), (I-749)+(1.084)+(15.047), (I-749)+(1.084)+(15.063), (I-749)+(1.084)+(15.064), (I-749)+(1.084)+(16.001), (I-749)+(1.084)+(16.002), (I-749)+(1.084)+(16.003), (I-749)+(1.084)+(16.004), (I-749)+(1.084)+(16.005), (I-749)+(1.084)+(16.006), (I-749)+(1.084)+(16.007), (I-749)+(1.084)+(16.008), (I-749)+(1.084)+(17.001), (I-749)+(1.084)+(17.002), (I-749)+(1.084)+(17.003), (I-749)+(1.084)+(17.004), (I-749)+(1.084)+(17.005), (I-749)+(1.084)+(17.006), (I-749)+(1.084)+(17.007), (I-749)+(1.084)+(17.008), (I-749)+(1.084)+(17.009), (I-749)+(1.084)+(17.010), (I-749)+(1.084)+(17.011), (I-749)+(1.084)+(17.012), (I-749)+(1.084)+(18.001),

(I-749)+(1.085)+(1.086), (I-749)+(1.085)+(1.087), (I-749)+(1.085)+(1.088), (I-749)+(1.085)+(1.089), (I-749)+(1.085)+(1.090), (I-749)+(1.085)+(1.091), (I-749)+(1.085)+(1.092), (I-749)+(1.085)+(2.001), (I-749)+(1.085)+(2.002), (I-749)+(1.085)+(2.003), (I-749)+(1.085)+(2.004), (I-749)+(1.085)+(2.005), (I-749)+(1.085)+(2.006), (I-749)+(1.085)+(2.007), (I-749)+(1.085)+(2.008), (I-749)+(1.085)+(2.009), (I-749)+(1.085)+(2.010), (I-749)+(1.085)+(2.011), (I-749)+(1.085)+(2.012), (I-749)+(1.085)+(2.013), (I-749)+(1.085)+(2.014), (I-749)+(1.085)+(2.015), (I-749)+(1.085)+(2.016), (I-749)+(1.085)+(2.017), (I-749)+(1.085)+(2.018), (I-749)+(1.085)+(2.019), (I-749)+(1.085)+(2.020), (I-749)+(1.085)+(2.021), (I-749)+(1.085)+(2.022), (I-749)+(1.085)+(2.023), (I-749)+(1.085)+(2.024), (I-749)+(1.085)+(2.025), (I-749)+(1.085)+(2.026), (I-749)+(1.085)+(2.027), (I-749)+(1.085)+(2.028), (I-749)+(1.085)+(2.029), (I-749)+(1.085)+(2.030), (I-749)+(1.085)+(2.031), (I-749)+(1.085)+(2.032), (I-749)+(1.085)+(2.033), (I-749)+(1.085)+(2.034), (I-749)+(1.085)+(2.035), (I-749)+(1.085)+(2.036), (I-749)+(1.085)+(2.037), (I-749)+(1.085)+(2.038), (I-749)+(1.085)+(2.039), (I-749)+(1.085)+(2.040), (I-749)+(1.085)+(2.041), (I-749)+(1.085)+(2.042), (I-749)+(1.085)+(2.043), (I-749)+(1.085)+(2.044), (I-749)+(1.085)+(2.045), (I-749)+(1.085)+(2.046), (I-749)+(1.085)+(2.047), (I-749)+(1.085)+(2.048), (I-749)+(1.085)+(2.049), (I-749)+(1.085)+(2.050), (I-749)+(1.085)+(2.051), (I-749)+(1.085)+(2.052), (I-749)+(1.085)+(2.053), (I-749)+(1.085)+(2.054), (I-749)+(1.085)+(2.055), (I-749)+(1.085)+(2.056), (I-749)+(1.085)+(2.057), (I-749)+(1.085)+(2.058), (I-749)+(1.085)+(2.059), (I-749)+(1.085)+(3.001), (I-749)+(1.085)+(3.002), (I-749)+(1.085)+(3.003), (I-749)+(1.085)+(3.004), (I-749)+(1.085)+(3.005), (I-749)+(1.085)+(3.006), (I-749)+(1.085)+(3.007), (I-749)+(1.085)+(3.008), (I-749)+(1.085)+(3.009), (I-749)+(1.085)+(3.010), (I-749)+(1.085)+(3.011), (I-749)+(1.085)+(3.012), (I-749)+(1.085)+(3.013), (I-749)+(1.085)+(3.014), (I-749)+(1.085)+(3.015), (I-749)+(1.085)+(3.016), (I-749)+(1.085)+(3.017), (I-749)+(1.085)+(3.018), (I-749)+(1.085)+(3.019), (I-749)+(1.085)+(3.020), (I-749)+(1.085)+(3.021), (I-749)+(1.085)+(3.022), (I-749)+(1.085)+(3.023), (I-749)+(1.085)+(3.024), (I-749)+(1.085)+(3.025), (I-749)+(1.085)+(3.026), (I-749)+(1.085)+(3.027), (I-749)+(1.085)+(3.028), (I-749)+(1.085)+(3.029), (I-749)+(1.085)+(3.030), (I-749)+(1.085)+(3.031), (I-749)+(1.085)+(5.001), (I-749)+(1.085)+(5.002), (I-749)+(1.085)+(5.003), (I-749)+(1.085)+(5.004), (I-749)+(1.085)+(5.005), (I-749)+(1.085)+(5.006), (I-749)+(1.085)+(5.007), (I-749)+(1.085)+(5.008), (I-749)+(1.085)+(5.009), (I-749)+(1.085)+(5.010), (I-749)+(1.085)+(5.011), (I-749)+(1.085)+(5.012), (I-749)+(1.085)+(5.013), (I-749)+(1.085)+(5.014), (I-749)+(1.085)+(5.015), (I-749)+(1.085)+(5.016), (I-749)+(1.085)+(5.017), (I-749)+(1.085)+(5.018), (I-749)+(1.085)+(5.019), (I-749)+(1.085)+(5.020), (I-749)+(1.085)+(5.021), (I-749)+(1.085)+(5.022), (I-749)+(1.085)+(5.023), (I-749)+(1.085)+(6.001), (I-749)+(1.085)+(6.002), (I-749)+(1.085)+(6.003), (I-749)+(1.085)+(6.004), (I-749)+(1.085)+(7.001), (I-749)+(1.085)+(7.002), (I-749)+(1.085)+(7.003), (I-749)+(1.085)+(7.004), (I-749)+(1.085)+(7.005), (I-749)+(1.085)+(7.006), (I-749)+(1.085)+(9.001), (I-749)+(1.085)+(9.002), (I-749)+(1.085)+(9.003), (I-749)+(1.085)+(9.004), (I-749)+(1.085)+(9.005), (I-749)+(1.085)+(9.006), (I-749)+(1.085)+(9.007), (I-749)+(1.085)+(9.008), (I-749)+(1.085)+(9.009), (I-749)+(1.085)+(14.001), (I-749)+(1.085)+(14.002), (I-749)+(1.085)+(15.008), (I-749)+(1.085)+(15.011), (I-749)+(1.085)+(15.012), (I-749)+(1.085)+(15.016), (I-749)+(1.085)+(15.025), (I-749)+(1.085)+(15.027), (I-749)+(1.085)+(15.047), (I-749)+(1.085)+(15.063), (I-749)+(1.085)+(15.064), (I-749)+(1.085)+(16.001), (I-749)+(1.085)+(16.002), (I-749)+(1.085)+(16.003), (I-749)+(1.085)+(16.004), (I-749)+(1.085)+(16.005), (I-749)+(1.085)+(16.006), (I-749)+(1.085)+(16.007), (I-749)+(1.085)+(16.008), (I-749)+(1.085)+(17.001), (I-749)+(1.085)+(17.002), (I-749)+(1.085)+(17.003), (I-749)+(1.085)+(17.004), (I-749)+(1.085)+(17.005), (I-749)+(1.085)+(17.006), (I-749)+(1.085)+(17.007), (I-749)+(1.085)+(17.008), (I-749)+(1.085)+(17.009), (I-749)+(1.085)+(17.010), (I-749)+(1.085)+(17.011), (I-749)+(1.085)+(17.012), (I-749)+(1.085)+(18.001),

(I-749)+(1.086)+(1.087), (I-749)+(1.086)+(1.088), (I-749)+(1.086)+(1.089), (I-749)+(1.086)+(1.090), (I-749)+(1.086)+(1.091), (I-749)+(1.086)+(1.092), (I-749)+(1.086)+(2.001), (I-749)+(1.086)+(2.002), (I-749)+(1.086)+(2.003), (I-749)+(1.086)+(2.004), (I-749)+(1.086)+(2.005), (I-749)+(1.086)+(2.006), (I-749)+(1.086)+(2.007), (I-749)+(1.086)+(2.008), (I-749)+(1.086)+(2.009), (I-749)+(1.086)+(2.010), (I-749)+(1.086)+(2.011), (I-749)+(1.086)+(2.012), (I-749)+(1.086)+(2.013), (I-749)+(1.086)+(2.014), (I-749)+(1.086)+(2.015), (I-749)+(1.086)+(2.016), (I-749)+(1.086)+(2.017), (I-749)+(1.086)+(2.018), (I-749)+(1.086)+(2.019), (I-749)+(1.086)+(2.020), (I-749)+(1.086)+(2.021), (I-749)+(1.086)+(2.022), (I-749)+(1.086)+(2.023), (I-749)+(1.086)+(2.024), (I-749)+(1.086)+(2.025), (I-749)+(1.086)+(2.026), (I-749)+(1.086)+(2.027), (I-749)+(1.086)+(2.028), (I-749)+(1.086)+(2.029), (I-749)+(1.086)+(2.030), (I-749)+(1.086)+(2.031), (I-749)+(1.086)+(2.032), (I-749)+(1.086)+(2.033), (I-749)+(1.086)+(2.034), (I-749)+(1.086)+(2.035), (I-749)+(1.086)+(2.036), (I-749)+(1.086)+(2.037), (I-749)+(1.086)+(2.038), (I-749)+(1.086)+(2.039), (I-749)+(1.086)+(2.040), (I-749)+(1.086)+(2.041), (I-749)+(1.086)+(2.042), (I-749)+(1.086)+(2.043), (I-749)+(1.086)+(2.044), (I-749)+(1.086)+(2.045), (I-749)+(1.086)+(2.046), (I-749)+(1.086)+(2.047), (I-749)+(1.086)+(2.048), (I-749)+(1.086)+(2.049), (I-749)+(1.086)+(2.050), (I-749)+(1.086)+(2.051), (I-749)+(1.086)+(2.052), (I-749)+(1.086)+(2.053), (I-749)+(1.086)+(2.054), (I-749)+(1.086)+(2.055), (I-749)+(1.086)+(2.056), (I-749)+(1.086)+(2.057), (I-749)+(1.086)+(2.058), (I-749)+(1.086)+(2.059), (I-749)+(1.086)+(3.001), (I-749)+(1.086)+(3.002), (I-749)+(1.086)+(3.003), (I-749)+(1.086)+(3.004), (I-749)+(1.086)+(3.005), (I-749)+(1.086)+(3.006), (I-749)+(1.086)+(3.007), (I-749)+(1.086)+(3.008), (I-749)+(1.086)+(3.009), (I-749)+(1.086)+(3.010), (I-749)+(1.086)+(3.011), (I-749)+(1.086)+(3.012), (I-749)+(1.086)+(3.013), (I-749)+(1.086)+(3.014), (I-749)+(1.086)+(3.015), (I-749)+(1.086)+(3.016), (I-749)+(1.086)+(3.017), (I-749)+(1.086)+(3.018), (I-749)+(1.086)+(3.019), (I-749)+(1.086)+(3.020), (I-749)+(1.086)+(3.021), (I-749)+(1.086)+(3.022), (I-749)+(1.086)+(3.023), (I-749)+(1.086)+(3.024), (I-749)+(1.086)+(3.025), (I-749)+(1.086)+(3.026), (I-749)+(1.086)+(3.027), (I-749)+(1.086)+(3.028), (I-749)+(1.086)+(3.029), (I-749)+(1.086)+(3.030), (I-749)+(1.086)+(3.031), (I-749)+(1.086)+(5.001), (I-749)+(1.086)+(5.002), (I-749)+(1.086)+(5.003), (I-749)+(1.086)+(5.004), (I-749)+(1.086)+(5.005), (I-749)+(1.086)+(5.006), (I-749)+(1.086)+(5.007), (I-749)+(1.086)+(5.008), (I-749)+(1.086)+(5.009), (I-749)+(1.086)+(5.010), (I-749)+(1.086)+(5.011), (I-749)+(1.086)+(5.012), (I-749)+(1.086)+(5.013), (I-749)+(1.086)+(5.014), (I-749)+(1.086)+(5.015), (I-749)+(1.086)+(5.016), (I-749)+(1.086)+(5.017), (I-749)+(1.086)+(5.018), (I-749)+(1.086)+(5.019), (I-749)+(1.086)+(5.020), (I-749)+(1.086)+(5.021), (I-749)+(1.086)+(5.022), (I-749)+(1.086)+(5.023), (I-749)+(1.086)+(6.001), (I-749)+(1.086)+(6.002), (I-749)+(1.086)+(6.003), (I-749)+(1.086)+(6.004), (I-749)+(1.086)+(7.001), (I-749)+(1.086)+(7.002), (I-749)+(1.086)+(7.003), (I-749)+(1.086)+(7.004), (I-749)+(1.086)+(7.005), (I-749)+(1.086)+(7.006), (I-749)+(1.086)+(9.001), (I-749)+(1.086)+(9.002), (I-749)+(1.086)+(9.003), (I-749)+(1.086)+(9.004), (I-749)+(1.086)+(9.005), (I-749)+(1.086)+(9.006), (I-749)+(1.086)+(9.007), (I-749)+(1.086)+(9.008), (I-749)+(1.086)+(9.009), (I-749)+(1.086)+(14.001), (I-749)+(1.086)+(14.002), (I-749)+(1.086)+(15.008), (I-749)+(1.086)+(15.011), (I-749)+(1.086)+(15.012), (I-749)+(1.086)+(15.016), (I-749)+(1.086)+(15.025), (I-749)+(1.086)+(15.027), (I-749)+(1.086)+(15.047), (I-749)+(1.086)+(15.063), (I-749)+(1.086)+(15.064), (I-749)+(1.086)+(16.001), (I-749)+(1.086)+(16.002), (I-749)+(1.086)+(16.003), (I-749)+(1.086)+(16.004), (I-749)+(1.086)+(16.005), (I-749)+(1.086)+(16.006), (I-749)+(1.086)+(16.007), (I-749)+(1.086)+(16.008), (I-749)+(1.086)+(17.001), (I-749)+(1.086)+(17.002), (I-749)+(1.086)+(17.003), (I-749)+(1.086)+(17.004), (I-749)+(1.086)+(17.005), (I-749)+(1.086)+(17.006), (I-749)+(1.086)+(17.007), (I-749)+(1.086)+(17.008), (I-749)+(1.086)+(17.009), (I-749)+(1.086)+(17.010), (I-749)+(1.086)+(17.011), (I-749)+(1.086)+(17.012), (I-749)+(1.086)+(18.001),

(I-749)+(1.087)+(1.088), (I-749)+(1.087)+(1.089), (I-749)+(1.087)+(1.090), (I-749)+(1.087)+(1.091), (I-749)+(1.087)+(1.092), (I-749)+(1.087)+(2.001), (I-749)+(1.087)+(2.002), (I-749)+(1.087)+(2.003), (I-749)+(1.087)+(2.004), (I-749)+(1.087)+(2.005), (I-749)+(1.087)+(2.006), (I-749)+(1.087)+(2.007), (I-749)+(1.087)+(2.008), (I-749)+(1.087)+(2.009), (I-749)+(1.087)+(2.010), (I-749)+(1.087)+(2.011), (I-749)+(1.087)+(2.012), (I-749)+(1.087)+(2.013), (I-749)+(1.087)+(2.014), (I-749)+(1.087)+(2.015), (I-749)+(1.087)+(2.016), (I-749)+(1.087)+(2.017), (I-749)+(1.087)+(2.018), (I-749)+(1.087)+(2.019), (I-749)+(1.087)+(2.020), (I-749)+(1.087)+(2.021), (I-749)+(1.087)+(2.022), (I-749)+(1.087)+(2.023), (I-749)+(1.087)+(2.024), (I-749)+(1.087)+(2.025), (I-749)+(1.087)+(2.026), (I-749)+(1.087)+(2.027), (I-749)+(1.087)+(2.028), (I-749)+(1.087)+(2.029), (I-749)+(1.087)+(2.030), (I-749)+(1.087)+(2.031), (I-749)+(1.087)+(2.032), (I-749)+(1.087)+(2.033), (I-749)+(1.087)+(2.034), (I-749)+(1.087)+(2.035), (I-749)+(1.087)+(2.036), (I-749)+(1.087)+(2.037), (I-749)+(1.087)+(2.038), (I-749)+(1.087)+(2.039), (I-749)+(1.087)+(2.040), (I-749)+(1.087)+(2.041), (I-749)+(1.087)+(2.042), (I-749)+(1.087)+(2.043), (I-749)+(1.087)+(2.044), (I-749)+(1.087)+(2.045), (I-749)+(1.087)+(2.046), (I-749)+(1.087)+(2.047), (I-749)+(1.087)+(2.048), (I-749)+(1.087)+(2.049), (I-749)+(1.087)+(2.050), (I-749)+(1.087)+(2.051), (I-749)+(1.087)+(2.052), (I-749)+(1.087)+(2.053), (I-749)+(1.087)+(2.054), (I-749)+(1.087)+(2.055), (I-749)+(1.087)+(2.056), (I-749)+(1.087)+(2.057), (I-749)+(1.087)+(2.058), (I-749)+(1.087)+(2.059), (I-749)+(1.087)+(3.001), (I-749)+(1.087)+(3.002), (I-749)+(1.087)+(3.003), (I-749)+(1.087)+(3.004), (I-749)+(1.087)+(3.005), (I-749)+(1.087)+(3.006), (I-749)+(1.087)+(3.007), (I-749)+(1.087)+(3.008), (I-749)+(1.087)+(3.009), (I-749)+(1.087)+(3.010), (I-749)+(1.087)+(3.011), (I-749)+(1.087)+(3.012), (I-749)+(1.087)+(3.013), (I-749)+(1.087)+(3.014), (I-749)+(1.087)+(3.015), (I-749)+(1.087)+(3.016), (I-749)+(1.087)+(3.017), (I-749)+(1.087)+(3.018), (I-749)+(1.087)+(3.019), (I-749)+(1.087)+(3.020), (I-749)+(1.087)+(3.021), (I-749)+(1.087)+(3.022), (I-749)+(1.087)+(3.023), (I-749)+(1.087)+(3.024), (I-749)+(1.087)+(3.025), (I-749)+(1.087)+(3.026), (I-749)+(1.087)+(3.027), (I-749)+(1.087)+(3.028), (I-749)+(1.087)+(3.029), (I-749)+(1.087)+(3.030), (I-749)+(1.087)+(3.031), (I-749)+(1.087)+(5.001), (I-749)+(1.087)+(5.002), (I-749)+(1.087)+(5.003), (I-749)+(1.087)+(5.004), (I-749)+(1.087)+(5.005), (I-749)+(1.087)+(5.006), (I-749)+(1.087)+(5.007), (I-749)+(1.087)+(5.008), (I-749)+(1.087)+(5.009), (I-749)+(1.087)+(5.010), (I-749)+(1.087)+(5.011), (I-749)+(1.087)+(5.012), (I-749)+(1.087)+(5.013), (I-749)+(1.087)+(5.014), (I-749)+(1.087)+(5.015), (I-749)+(1.087)+(5.016), (I-749)+(1.087)+(5.017), (I-749)+(1.087)+(5.018), (I-749)+(1.087)+(5.019), (I-749)+(1.087)+(5.020), (I-749)+(1.087)+(5.021), (I-749)+(1.087)+(5.022), (I-749)+(1.087)+(5.023), (I-749)+(1.087)+(6.001), (I-749)+(1.087)+(6.002), (I-749)+(1.087)+(6.003), (I-749)+(1.087)+(6.004), (I-749)+(1.087)+(7.001), (I-749)+(1.087)+(7.002), (I-749)+(1.087)+(7.003), (I-749)+(1.087)+(7.004), (I-749)+(1.087)+(7.005), (I-749)+(1.087)+(7.006), (I-749)+(1.087)+(9.001), (I-749)+(1.087)+(9.002), (I-749)+(1.087)+(9.003), (I-749)+(1.087)+(9.004), (I-749)+(1.087)+(9.005), (I-749)+(1.087)+(9.006), (I-749)+(1.087)+(9.007), (I-749)+(1.087)+(9.008), (I-749)+(1.087)+(9.009), (I-749)+(1.087)+(14.001), (I-749)+(1.087)+(14.002), (I-749)+(1.087)+(15.008), (I-749)+(1.087)+(15.011), (I-749)+(1.087)+(15.012), (I-749)+(1.087)+(15.016), (I-749)+(1.087)+(15.025), (I-749)+(1.087)+(15.027), (I-749)+(1.087)+(15.047), (I-749)+(1.087)+(15.063), (I-749)+(1.087)+(15.064), (I-749)+(1.087)+(16.001), (I-749)+(1.087)+(16.002), (I-749)+(1.087)+(16.003), (I-749)+(1.087)+(16.004), (I-749)+(1.087)+(16.005), (I-749)+(1.087)+(16.006), (I-749)+(1.087)+(16.007), (I-749)+(1.087)+(16.008), (I-749)+(1.087)+(17.001), (I-749)+(1.087)+(17.002), (I-749)+(1.087)+(17.003), (I-749)+(1.087)+(17.004), (I-749)+(1.087)+(17.005), (I-749)+(1.087)+(17.006), (I-749)+(1.087)+(17.007), (I-749)+(1.087)+(17.008), (I-749)+(1.087)+(17.009), (I-749)+(1.087)+(17.010), (I-749)+(1.087)+(17.011), (I-749)+(1.087)+(17.012), (I-749)+(1.087)+(18.001),

(I-749)+(1.088)+(1.089), (I-749)+(1.088)+(1.090), (I-749)+(1.088)+(1.091), (I-749)+(1.088)+(1.092), (I-749)+(1.088)+(2.001), (I-749)+(1.088)+(2.002), (I-749)+(1.088)+(2.003), (I-749)+(1.088)+(2.004), (I-749)+(1.088)+(2.005), (I-749)+(1.088)+(2.006), (I-749)+(1.088)+(2.007), (I-749)+(1.088)+(2.008), (I-749)+(1.088)+(2.009), (I-749)+(1.088)+(2.010), (I-749)+(1.088)+(2.011), (I-749)+(1.088)+(2.012), (I-749)+(1.088)+(2.013), (I-749)+(1.088)+(2.014), (I-749)+(1.088)+(2.015), (I-749)+(1.088)+(2.016), (I-749)+(1.088)+(2.017), (I-749)+(1.088)+(2.018), (I-749)+(1.088)+(2.019), (I-749)+(1.088)+(2.020), (I-749)+(1.088)+(2.021), (I-749)+(1.088)+(2.022), (I-749)+(1.088)+(2.023), (I-749)+(1.088)+(2.024), (I-749)+(1.088)+(2.025), (I-749)+(1.088)+(2.026), (I-749)+(1.088)+(2.027), (I-749)+(1.088)+(2.028), (I-749)+(1.088)+(2.029), (I-749)+(1.088)+(2.030), (I-749)+(1.088)+(2.031), (I-749)+(1.088)+(2.032), (I-749)+(1.088)+(2.033), (I-749)+(1.088)+(2.034), (I-749)+(1.088)+(2.035), (I-749)+(1.088)+(2.036), (I-749)+(1.088)+(2.037), (I-749)+(1.088)+(2.038), (I-749)+(1.088)+(2.039), (I-749)+(1.088)+(2.040), (I-749)+(1.088)+(2.041), (I-749)+(1.088)+(2.042), (I-749)+(1.088)+(2.043), (I-749)+(1.088)+(2.044), (I-749)+(1.088)+(2.045), (I-749)+(1.088)+(2.046), (I-749)+(1.088)+(2.047), (I-749)+(1.088)+(2.048), (I-749)+(1.088)+(2.049), (I-749)+(1.088)+(2.050), (I-749)+(1.088)+(2.051), (I-749)+(1.088)+(2.052), (I-749)+(1.088)+(2.053), (I-749)+(1.088)+(2.054), (I-749)+(1.088)+(2.055), (I-749)+(1.088)+(2.056), (I-749)+(1.088)+(2.057), (I-749)+(1.088)+(2.058), (I-749)+(1.088)+(2.059), (I-749)+(1.088)+(3.001), (I-749)+(1.088)+(3.002), (I-749)+(1.088)+(3.003), (I-749)+(1.088)+(3.004), (I-749)+(1.088)+(3.005), (I-749)+(1.088)+(3.006), (I-749)+(1.088)+(3.007), (I-749)+(1.088)+(3.008), (I-749)+(1.088)+(3.009), (I-749)+(1.088)+(3.010), (I-749)+(1.088)+(3.011), (I-749)+(1.088)+(3.012), (I-749)+(1.088)+(3.013), (I-749)+(1.088)+(3.014), (I-749)+(1.088)+(3.015), (I-749)+(1.088)+(3.016), (I-749)+(1.088)+(3.017), (I-749)+(1.088)+(3.018), (I-749)+(1.088)+(3.019), (I-749)+(1.088)+(3.020), (I-749)+(1.088)+(3.021), (I-749)+(1.088)+(3.022), (I-749)+(1.088)+(3.023), (I-749)+(1.088)+(3.024), (I-749)+(1.088)+(3.025), (I-749)+(1.088)+(3.026), (I-749)+(1.088)+(3.027), (I-749)+(1.088)+(3.028), (I-749)+(1.088)+(3.029), (I-749)+(1.088)+(3.030), (I-749)+(1.088)+(3.031), (I-749)+(1.088)+(5.001), (I-749)+(1.088)+(5.002), (I-749)+(1.088)+(5.003), (I-749)+(1.088)+(5.004), (I-749)+(1.088)+(5.005), (I-749)+(1.088)+(5.006), (I-749)+(1.088)+(5.007), (I-749)+(1.088)+(5.008), (I-749)+(1.088)+(5.009), (I-749)+(1.088)+(5.010), (I-749)+(1.088)+(5.011), (I-749)+(1.088)+(5.012), (I-749)+(1.088)+(5.013), (I-749)+(1.088)+(5.014), (I-749)+(1.088)+(5.015), (I-749)+(1.088)+(5.016), (I-749)+(1.088)+(5.017), (I-749)+(1.088)+(5.018), (I-749)+(1.088)+(5.019), (I-749)+(1.088)+(5.020), (I-749)+(1.088)+(5.021), (I-749)+(1.088)+(5.022), (I-749)+(1.088)+(5.023), (I-749)+(1.088)+(6.001), (I-749)+(1.088)+(6.002), (I-749)+(1.088)+(6.003), (I-749)+(1.088)+(6.004), (I-749)+(1.088)+(7.001), (I-749)+(1.088)+(7.002), (I-749)+(1.088)+(7.003), (I-749)+(1.088)+(7.004), (I-749)+(1.088)+(7.005), (I-749)+(1.088)+(7.006), (I-749)+(1.088)+(9.001), (I-749)+(1.088)+(9.002), (I-749)+(1.088)+(9.003), (I-749)+(1.088)+(9.004), (I-749)+(1.088)+(9.005), (I-749)+(1.088)+(9.006), (I-749)+(1.088)+(9.007), (I-749)+(1.088)+(9.008), (I-749)+(1.088)+(9.009), (I-749)+(1.088)+(14.001), (I-749)+(1.088)+(14.002), (I-749)+(1.088)+(15.008), (I-749)+(1.088)+(15.011), (I-749)+(1.088)+(15.012), (I-749)+(1.088)+(15.016), (I-749)+(1.088)+(15.025), (I-749)+(1.088)+(15.027), (I-749)+(1.088)+(15.047), (I-749)+(1.088)+(15.063), (I-749)+(1.088)+(15.064), (I-749)+(1.088)+(16.001), (I-749)+(1.088)+(16.002), (I-749)+(1.088)+(16.003), (I-749)+(1.088)+(16.004), (I-749)+(1.088)+(16.005), (I-749)+(1.088)+(16.006), (I-749)+(1.088)+(16.007), (I-749)+(1.088)+(16.008), (I-749)+(1.088)+(17.001), (I-749)+(1.088)+(17.002), (I-749)+(1.088)+(17.003), (I-749)+(1.088)+(17.004), (I-749)+(1.088)+(17.005), (I-749)+(1.088)+(17.006), (I-749)+(1.088)+(17.007), (I-749)+(1.088)+(17.008), (I-749)+(1.088)+(17.009), (I-749)+(1.088)+(17.010), (I-749)+(1.088)+(17.011), (I-749)+(1.088)+(17.012), (I-749)+(1.088)+(18.001),

(I-749)+(1.089)+(1.090), (I-749)+(1.089)+(1.091), (I-749)+(1.089)+(1.092), (I-749)+(1.089)+(2.001), (I-749)+(1.089)+(2.002), (I-749)+(1.089)+(2.003), (I-749)+(1.089)+(2.004), (I-749)+(1.089)+(2.005), (I-749)+(1.089)+(2.006), (I-749)+(1.089)+(2.007), (I-749)+(1.089)+(2.008), (I-749)+(1.089)+(2.009), (I-749)+(1.089)+(2.010), (I-749)+(1.089)+(2.011), (I-749)+(1.089)+(2.012), (I-749)+(1.089)+(2.013), (I-749)+(1.089)+(2.014), (I-749)+(1.089)+(2.015), (I-749)+(1.089)+(2.016), (I-749)+(1.089)+(2.017), (I-749)+(1.089)+(2.018), (I-749)+(1.089)+(2.019), (I-749)+(1.089)+(2.020), (I-749)+(1.089)+(2.021), (I-749)+(1.089)+(2.022), (I-749)+(1.089)+(2.023), (I-749)+(1.089)+(2.024), (I-749)+(1.089)+(2.025), (I-749)+(1.089)+(2.026), (I-749)+(1.089)+(2.027), (I-749)+(1.089)+(2.028), (I-749)+(1.089)+(2.029), (I-749)+(1.089)+(2.030), (I-749)+(1.089)+(2.031), (I-749)+(1.089)+(2.032), (I-749)+(1.089)+(2.033), (I-749)+(1.089)+(2.034), (I-749)+(1.089)+(2.035), (I-749)+(1.089)+(2.036), (I-749)+(1.089)+(2.037), (I-749)+(1.089)+(2.038), (I-749)+(1.089)+(2.039), (I-749)+(1.089)+(2.040), (I-749)+(1.089)+(2.041), (I-749)+(1.089)+(2.042), (I-749)+(1.089)+(2.043), (I-749)+(1.089)+(2.044), (I-749)+(1.089)+(2.045), (I-749)+(1.089)+(2.046), (I-749)+(1.089)+(2.047), (I-749)+(1.089)+(2.048), (I-749)+(1.089)+(2.049), (I-749)+(1.089)+(2.050), (I-749)+(1.089)+(2.051), (I-749)+(1.089)+(2.052), (I-749)+(1.089)+(2.053), (I-749)+(1.089)+(2.054), (I-749)+(1.089)+(2.055), (I-749)+(1.089)+(2.056), (I-749)+(1.089)+(2.057), (I-749)+(1.089)+(2.058), (I-749)+(1.089)+(2.059), (I-749)+(1.089)+(3.001), (I-749)+(1.089)+(3.002), (I-749)+(1.089)+(3.003), (I-749)+(1.089)+(3.004), (I-749)+(1.089)+(3.005), (I-749)+(1.089)+(3.006), (I-749)+(1.089)+(3.007), (I-749)+(1.089)+(3.008), (I-749)+(1.089)+(3.009), (I-749)+(1.089)+(3.010), (I-749)+(1.089)+(3.011), (I-749)+(1.089)+(3.012), (I-749)+(1.089)+(3.013), (I-749)+(1.089)+(3.014), (I-749)+(1.089)+(3.015), (I-749)+(1.089)+(3.016), (I-749)+(1.089)+(3.017), (I-749)+(1.089)+(3.018), (I-749)+(1.089)+(3.019), (I-749)+(1.089)+(3.020), (I-749)+(1.089)+(3.021), (I-749)+(1.089)+(3.022), (I-749)+(1.089)+(3.023), (I-749)+(1.089)+(3.024), (I-749)+(1.089)+(3.025), (I-749)+(1.089)+(3.026), (I-749)+(1.089)+(3.027), (I-749)+(1.089)+(3.028), (I-749)+(1.089)+(3.029), (I-749)+(1.089)+(3.030), (I-749)+(1.089)+(3.031), (I-749)+(1.089)+(5.001), (I-749)+(1.089)+(5.002), (I-749)+(1.089)+(5.003), (I-749)+(1.089)+(5.004), (I-749)+(1.089)+(5.005), (I-749)+(1.089)+(5.006), (I-749)+(1.089)+(5.007), (I-749)+(1.089)+(5.008), (I-749)+(1.089)+(5.009), (I-749)+(1.089)+(5.010), (I-749)+(1.089)+(5.011), (I-749)+(1.089)+(5.012), (I-749)+(1.089)+(5.013), (I-749)+(1.089)+(5.014), (I-749)+(1.089)+(5.015), (I-749)+(1.089)+(5.016), (I-749)+(1.089)+(5.017), (I-749)+(1.089)+(5.018), (I-749)+(1.089)+(5.019), (I-749)+(1.089)+(5.020), (I-749)+(1.089)+(5.021), (I-749)+(1.089)+(5.022), (I-749)+(1.089)+(5.023), (I-749)+(1.089)+(6.001), (I-749)+(1.089)+(6.002), (I-749)+(1.089)+(6.003), (I-749)+(1.089)+(6.004), (I-749)+(1.089)+(7.001), (I-749)+(1.089)+(7.002), (I-749)+(1.089)+(7.003), (I-749)+(1.089)+(7.004), (I-749)+(1.089)+(7.005), (I-749)+(1.089)+(7.006), (I-749)+(1.089)+(9.001), (I-749)+(1.089)+(9.002), (I-749)+(1.089)+(9.003), (I-749)+(1.089)+(9.004), (I-749)+(1.089)+(9.005), (I-749)+(1.089)+(9.006), (I-749)+(1.089)+(9.007), (I-749)+(1.089)+(9.008), (I-749)+(1.089)+(9.009), (I-749)+(1.089)+(14.001), (I-749)+(1.089)+(14.002), (I-749)+(1.089)+(15.008), (I-749)+(1.089)+(15.011), (I-749)+(1.089)+(15.012), (I-749)+(1.089)+(15.016), (I-749)+(1.089)+(15.025), (I-749)+(1.089)+(15.027), (I-749)+(1.089)+(15.047), (I-749)+(1.089)+(15.063), (I-749)+(1.089)+(15.064), (I-749)+(1.089)+(16.001), (I-749)+(1.089)+(16.002), (I-749)+(1.089)+(16.003), (I-749)+(1.089)+(16.004), (I-749)+(1.089)+(16.005), (I-749)+(1.089)+(16.006), (I-749)+(1.089)+(16.007), (I-749)+(1.089)+(16.008), (I-749)+(1.089)+(17.001), (I-749)+(1.089)+(17.002), (I-749)+(1.089)+(17.003), (I-749)+(1.089)+(17.004), (I-749)+(1.089)+(17.005), (I-749)+(1.089)+(17.006), (I-749)+(1.089)+(17.007), (I-749)+(1.089)+(17.008), (I-749)+(1.089)+(17.009), (I-749)+(1.089)+(17.010), (I-749)+(1.089)+(17.011), (I-749)+(1.089)+(17.012), (I-749)+(1.089)+(18.001),

(I-749)+(1.090)+(1.091), (I-749)+(1.090)+(1.092), (I-749)+(1.090)+(2.001), (I-749)+(1.090)+(2.002), (I-749)+(1.090)+(2.003), (I-749)+(1.090)+(2.004), (I-749)+(1.090)+(2.005), (I-749)+(1.090)+(2.006), (I-749)+(1.090)+(2.007), (I-749)+(1.090)+(2.008), (I-749)+(1.090)+(2.009), (I-749)+(1.090)+(2.010), (I-749)+(1.090)+(2.011), (I-749)+(1.090)+(2.012), (I-749)+(1.090)+(2.013), (I-749)+(1.090)+(2.014), (I-749)+(1.090)+(2.015), (I-749)+(1.090)+(2.016), (I-749)+(1.090)+(2.017), (I-749)+(1.090)+(2.018), (I-749)+(1.090)+(2.019), (I-749)+(1.090)+(2.020), (I-749)+(1.090)+(2.021), (I-749)+(1.090)+(2.022), (I-749)+(1.090)+(2.023), (I-749)+(1.090)+(2.024), (I-749)+(1.090)+(2.025), (I-749)+(1.090)+(2.026), (I-749)+(1.090)+(2.027), (I-749)+(1.090)+(2.028), (I-749)+(1.090)+(2.029), (I-749)+(1.090)+(2.030), (I-749)+(1.090)+(2.031), (I-749)+(1.090)+(2.032), (I-749)+(1.090)+(2.033), (I-749)+(1.090)+(2.034), (I-749)+(1.090)+(2.035), (I-749)+(1.090)+(2.036), (I-749)+(1.090)+(2.037), (I-749)+(1.090)+(2.038), (I-749)+(1.090)+(2.039), (I-749)+(1.090)+(2.040), (I-749)+(1.090)+(2.041), (I-749)+(1.090)+(2.042), (I-749)+(1.090)+(2.043), (I-749)+(1.090)+(2.044), (I-749)+(1.090)+(2.045), (I-749)+(1.090)+(2.046), (I-749)+(1.090)+(2.047), (I-749)+(1.090)+(2.048), (I-749)+(1.090)+(2.049), (I-749)+(1.090)+(2.050), (I-749)+(1.090)+(2.051), (I-749)+(1.090)+(2.052), (I-749)+(1.090)+(2.053), (I-749)+(1.090)+(2.054), (I-749)+(1.090)+(2.055), (I-749)+(1.090)+(2.056), (I-749)+(1.090)+(2.057), (I-749)+(1.090)+(2.058), (I-749)+(1.090)+(2.059), (I-749)+(1.090)+(3.001), (I-749)+(1.090)+(3.002), (I-749)+(1.090)+(3.003), (I-749)+(1.090)+(3.004), (I-749)+(1.090)+(3.005), (I-749)+(1.090)+(3.006), (I-749)+(1.090)+(3.007), (I-749)+(1.090)+(3.008), (I-749)+(1.090)+(3.009), (I-749)+(1.090)+(3.010), (I-749)+(1.090)+(3.011), (I-749)+(1.090)+(3.012), (I-749)+(1.090)+(3.013), (I-749)+(1.090)+(3.014), (I-749)+(1.090)+(3.015), (I-749)+(1.090)+(3.016), (I-749)+(1.090)+(3.017), (I-749)+(1.090)+(3.018), (I-749)+(1.090)+(3.019), (I-749)+(1.090)+(3.020), (I-749)+(1.090)+(3.021), (I-749)+(1.090)+(3.022), (I-749)+(1.090)+(3.023), (I-749)+(1.090)+(3.024), (I-749)+(1.090)+(3.025), (I-749)+(1.090)+(3.026), (I-749)+(1.090)+(3.027), (I-749)+(1.090)+(3.028), (I-749)+(1.090)+(3.029), (I-749)+(1.090)+(3.030), (I-749)+(1.090)+(3.031), (I-749)+(1.090)+(5.001), (I-749)+(1.090)+(5.002), (I-749)+(1.090)+(5.003), (I-749)+(1.090)+(5.004), (I-749)+(1.090)+(5.005), (I-749)+(1.090)+(5.006), (I-749)+(1.090)+(5.007), (I-749)+(1.090)+(5.008), (I-749)+(1.090)+(5.009), (I-749)+(1.090)+(5.010), (I-749)+(1.090)+(5.011), (I-749)+(1.090)+(5.012), (I-749)+(1.090)+(5.013), (I-749)+(1.090)+(5.014), (I-749)+(1.090)+(5.015), (I-749)+(1.090)+(5.016), (I-749)+(1.090)+(5.017), (I-749)+(1.090)+(5.018), (I-749)+(1.090)+(5.019), (I-749)+(1.090)+(5.020), (I-749)+(1.090)+(5.021), (I-749)+(1.090)+(5.022), (I-749)+(1.090)+(5.023), (I-749)+(1.090)+(6.001), (I-749)+(1.090)+(6.002), (I-749)+(1.090)+(6.003), (I-749)+(1.090)+(6.004), (I-749)+(1.090)+(7.001), (I-749)+(1.090)+(7.002), (I-749)+(1.090)+(7.003), (I-749)+(1.090)+(7.004), (I-749)+(1.090)+(7.005), (I-749)+(1.090)+(7.006), (I-749)+(1.090)+(9.001), (I-749)+(1.090)+(9.002), (I-749)+(1.090)+(9.003), (I-749)+(1.090)+(9.004), (I-749)+(1.090)+(9.005), (I-749)+(1.090)+(9.006), (I-749)+(1.090)+(9.007), (I-749)+(1.090)+(9.008), (I-749)+(1.090)+(9.009), (I-749)+(1.090)+(14.001), (I-749)+(1.090)+(14.002), (I-749)+(1.090)+(15.008), (I-749)+(1.090)+(15.011), (I-749)+(1.090)+(15.012), (I-749)+(1.090)+(15.016), (I-749)+(1.090)+(15.025), (I-749)+(1.090)+(15.027), (I-749)+(1.090)+(15.047), (I-749)+(1.090)+(15.063), (I-749)+(1.090)+(15.064), (I-749)+(1.090)+(16.001), (I-749)+(1.090)+(16.002), (I-749)+(1.090)+(16.003), (I-749)+(1.090)+(16.004), (I-749)+(1.090)+(16.005), (I-749)+(1.090)+(16.006), (I-749)+(1.090)+(16.007), (I-749)+(1.090)+(16.008), (I-749)+(1.090)+(17.001), (I-749)+(1.090)+(17.002), (I-749)+(1.090)+(17.003), (I-749)+(1.090)+(17.004), (I-749)+(1.090)+(17.005), (I-749)+(1.090)+(17.006), (I-749)+(1.090)+(17.007), (I-749)+(1.090)+(17.008), (I-749)+(1.090)+(17.009), (I-749)+(1.090)+(17.010), (I-749)+(1.090)+(17.011), (I-749)+(1.090)+(17.012), (I-749)+(1.090)+(18.001),

(I-749)+(1.091)+(1.092), (I-749)+(1.091)+(2.001), (I-749)+(1.091)+(2.002), (I-749)+(1.091)+(2.003), (I-749)+(1.091)+(2.004), (I-749)+(1.091)+(2.005), (I-749)+(1.091)+(2.006), (I-749)+(1.091)+(2.007), (I-749)+(1.091)+(2.008), (I-749)+(1.091)+(2.009), (I-749)+(1.091)+(2.010), (I-749)+(1.091)+(2.011), (I-749)+(1.091)+(2.012), (I-749)+(1.091)+(2.013), (I-749)+(1.091)+(2.014), (I-749)+(1.091)+(2.015), (I-749)+(1.091)+(2.016), (I-749)+(1.091)+(2.017), (I-749)+(1.091)+(2.018), (I-749)+(1.091)+(2.019), (I-749)+(1.091)+(2.020), (I-749)+(1.091)+(2.021), (I-749)+(1.091)+(2.022), (I-749)+(1.091)+(2.023), (I-749)+(1.091)+(2.024), (I-749)+(1.091)+(2.025), (I-749)+(1.091)+(2.026), (I-749)+(1.091)+(2.027), (I-749)+(1.091)+(2.028), (I-749)+(1.091)+(2.029), (I-749)+(1.091)+(2.030), (I-749)+(1.091)+(2.031), (I-749)+(1.091)+(2.032), (I-749)+(1.091)+(2.033), (I-749)+(1.091)+(2.034), (I-749)+(1.091)+(2.035), (I-749)+(1.091)+(2.036), (I-749)+(1.091)+(2.037), (I-749)+(1.091)+(2.038), (I-749)+(1.091)+(2.039), (I-749)+(1.091)+(2.040), (I-749)+(1.091)+(2.041), (I-749)+(1.091)+(2.042), (I-749)+(1.091)+(2.043), (I-749)+(1.091)+(2.044), (I-749)+(1.091)+(2.045), (I-749)+(1.091)+(2.046), (I-749)+(1.091)+(2.047), (I-749)+(1.091)+(2.048), (I-749)+(1.091)+(2.049), (I-749)+(1.091)+(2.050), (I-749)+(1.091)+(2.051), (I-749)+(1.091)+(2.052), (I-749)+(1.091)+(2.053), (I-749)+(1.091)+(2.054), (I-749)+(1.091)+(2.055), (I-749)+(1.091)+(2.056), (I-749)+(1.091)+(2.057), (I-749)+(1.091)+(2.058), (I-749)+(1.091)+(2.059), (I-749)+(1.091)+(3.001), (I-749)+(1.091)+(3.002), (I-749)+(1.091)+(3.003), (I-749)+(1.091)+(3.004), (I-749)+(1.091)+(3.005), (I-749)+(1.091)+(3.006), (I-749)+(1.091)+(3.007), (I-749)+(1.091)+(3.008), (I-749)+(1.091)+(3.009), (I-749)+(1.091)+(3.010), (I-749)+(1.091)+(3.011), (I-749)+(1.091)+(3.012), (I-749)+(1.091)+(3.013), (I-749)+(1.091)+(3.014), (I-749)+(1.091)+(3.015), (I-749)+(1.091)+(3.016), (I-749)+(1.091)+(3.017), (I-749)+(1.091)+(3.018), (I-749)+(1.091)+(3.019), (I-749)+(1.091)+(3.020), (I-749)+(1.091)+(3.021), (I-749)+(1.091)+(3.022), (I-749)+(1.091)+(3.023), (I-749)+(1.091)+(3.024), (I-749)+(1.091)+(3.025), (I-749)+(1.091)+(3.026), (I-749)+(1.091)+(3.027), (I-749)+(1.091)+(3.028), (I-749)+(1.091)+(3.029), (I-749)+(1.091)+(3.030), (I-749)+(1.091)+(3.031), (I-749)+(1.091)+(5.001), (I-749)+(1.091)+(5.002), (I-749)+(1.091)+(5.003), (I-749)+(1.091)+(5.004), (I-749)+(1.091)+(5.005), (I-749)+(1.091)+(5.006), (I-749)+(1.091)+(5.007), (I-749)+(1.091)+(5.008), (I-749)+(1.091)+(5.009), (I-749)+(1.091)+(5.010), (I-749)+(1.091)+(5.011), (I-749)+(1.091)+(5.012), (I-749)+(1.091)+(5.013), (I-749)+(1.091)+(5.014), (I-749)+(1.091)+(5.015), (I-749)+(1.091)+(5.016), (I-749)+(1.091)+(5.017), (I-749)+(1.091)+(5.018), (I-749)+(1.091)+(5.019), (I-749)+(1.091)+(5.020), (I-749)+(1.091)+(5.021), (I-749)+(1.091)+(5.022), (I-749)+(1.091)+(5.023), (I-749)+(1.091)+(6.001), (I-749)+(1.091)+(6.002), (I-749)+(1.091)+(6.003), (I-749)+(1.091)+(6.004), (I-749)+(1.091)+(7.001), (I-749)+(1.091)+(7.002), (I-749)+(1.091)+(7.003), (I-749)+(1.091)+(7.004), (I-749)+(1.091)+(7.005), (I-749)+(1.091)+(7.006), (I-749)+(1.091)+(9.001), (I-749)+(1.091)+(9.002), (I-749)+(1.091)+(9.003), (I-749)+(1.091)+(9.004), (I-749)+(1.091)+(9.005), (I-749)+(1.091)+(9.006), (I-749)+(1.091)+(9.007), (I-749)+(1.091)+(9.008), (I-749)+(1.091)+(9.009), (I-749)+(1.091)+(14.001), (I-749)+(1.091)+(14.002), (I-749)+(1.091)+(15.008), (I-749)+(1.091)+(15.011), (I-749)+(1.091)+(15.012), (I-749)+(1.091)+(15.016), (I-749)+(1.091)+(15.025), (I-749)+(1.091)+(15.027), (I-749)+(1.091)+(15.047), (I-749)+(1.091)+(15.063), (I-749)+(1.091)+(15.064), (I-749)+(1.091)+(16.001), (I-749)+(1.091)+(16.002), (I-749)+(1.091)+(16.003), (I-749)+(1.091)+(16.004), (I-749)+(1.091)+(16.005), (I-749)+(1.091)+(16.006), (I-749)+(1.091)+(16.007), (I-749)+(1.091)+(16.008), (I-749)+(1.091)+(17.001), (I-749)+(1.091)+(17.002), (I-749)+(1.091)+(17.003), (I-749)+(1.091)+(17.004), (I-749)+(1.091)+(17.005), (I-749)+(1.091)+(17.006), (I-749)+(1.091)+(17.007), (I-749)+(1.091)+(17.008), (I-749)+(1.091)+(17.009), (I-749)+(1.091)+(17.010), (I-749)+(1.091)+(17.011), (I-749)+(1.091)+(17.012), (I-749)+(1.091)+(18.001),

(I-749)+(1.092)+(2.001), (I-749)+(1.092)+(2.002), (I-749)+(1.092)+(2.003), (I-749)+(1.092)+(2.004), (I-749)+(1.092)+(2.005), (I-749)+(1.092)+(2.006), (I-749)+(1.092)+(2.007), (I-749)+(1.092)+(2.008), (I-749)+(1.092)+(2.009), (I-749)+(1.092)+(2.010), (I-749)+(1.092)+(2.011), (I-749)+(1.092)+(2.012), (I-749)+(1.092)+(2.013), (I-749)+(1.092)+(2.014), (I-749)+(1.092)+(2.015), (I-749)+(1.092)+(2.016), (I-749)+(1.092)+(2.017), (I-749)+(1.092)+(2.018), (I-749)+(1.092)+(2.019), (I-749)+(1.092)+(2.020), (I-749)+(1.092)+(2.021), (I-749)+(1.092)+(2.022), (I-749)+(1.092)+(2.023), (I-749)+(1.092)+(2.024), (I-749)+(1.092)+(2.025), (I-749)+(1.092)+(2.026), (I-749)+(1.092)+(2.027), (I-749)+(1.092)+(2.028), (I-749)+(1.092)+(2.029), (I-749)+(1.092)+(2.030), (I-749)+(1.092)+(2.031), (I-749)+(1.092)+(2.032), (I-749)+(1.092)+(2.033), (I-749)+(1.092)+(2.034), (I-749)+(1.092)+(2.035), (I-749)+(1.092)+(2.036), (I-749)+(1.092)+(2.037), (I-749)+(1.092)+(2.038), (I-749)+(1.092)+(2.039), (I-749)+(1.092)+(2.040), (I-749)+(1.092)+(2.041), (I-749)+(1.092)+(2.042), (I-749)+(1.092)+(2.043), (I-749)+(1.092)+(2.044), (I-749)+(1.092)+(2.045), (I-749)+(1.092)+(2.046), (I-749)+(1.092)+(2.047), (I-749)+(1.092)+(2.048), (I-749)+(1.092)+(2.049), (I-749)+(1.092)+(2.050), (I-749)+(1.092)+(2.051), (I-749)+(1.092)+(2.052), (I-749)+(1.092)+(2.053), (I-749)+(1.092)+(2.054), (I-749)+(1.092)+(2.055), (I-749)+(1.092)+(2.056), (I-749)+(1.092)+(2.057), (I-749)+(1.092)+(2.058), (I-749)+(1.092)+(2.059), (I-749)+(1.092)+(3.001), (I-749)+(1.092)+(3.002), (I-749)+(1.092)+(3.003), (I-749)+(1.092)+(3.004), (I-749)+(1.092)+(3.005), (I-749)+(1.092)+(3.006), (I-749)+(1.092)+(3.007), (I-749)+(1.092)+(3.008), (I-749)+(1.092)+(3.009), (I-749)+(1.092)+(3.010), (I-749)+(1.092)+(3.011), (I-749)+(1.092)+(3.012), (I-749)+(1.092)+(3.013), (I-749)+(1.092)+(3.014), (I-749)+(1.092)+(3.015), (I-749)+(1.092)+(3.016), (I-749)+(1.092)+(3.017), (I-749)+(1.092)+(3.018), (I-749)+(1.092)+(3.019), (I-749)+(1.092)+(3.020), (I-749)+(1.092)+(3.021), (I-749)+(1.092)+(3.022), (I-749)+(1.092)+(3.023), (I-749)+(1.092)+(3.024), (I-749)+(1.092)+(3.025), (I-749)+(1.092)+(3.026), (I-749)+(1.092)+(3.027), (I-749)+(1.092)+(3.028), (I-749)+(1.092)+(3.029), (I-749)+(1.092)+(3.030), (I-749)+(1.092)+(3.031), (I-749)+(1.092)+(5.001), (I-749)+(1.092)+(5.002), (I-749)+(1.092)+(5.003), (I-749)+(1.092)+(5.004), (I-749)+(1.092)+(5.005), (I-749)+(1.092)+(5.006), (I-749)+(1.092)+(5.007), (I-749)+(1.092)+(5.008), (I-749)+(1.092)+(5.009), (I-749)+(1.092)+(5.010), (I-749)+(1.092)+(5.011), (I-749)+(1.092)+(5.012), (I-749)+(1.092)+(5.013), (I-749)+(1.092)+(5.014), (I-749)+(1.092)+(5.015), (I-749)+(1.092)+(5.016), (I-749)+(1.092)+(5.017), (I-749)+(1.092)+(5.018), (I-749)+(1.092)+(5.019), (I-749)+(1.092)+(5.020), (I-749)+(1.092)+(5.021), (I-749)+(1.092)+(5.022), (I-749)+(1.092)+(5.023), (I-749)+(1.092)+(6.001), (I-749)+(1.092)+(6.002), (I-749)+(1.092)+(6.003), (I-749)+(1.092)+(6.004), (I-749)+(1.092)+(7.001), (I-749)+(1.092)+(7.002), (I-749)+(1.092)+(7.003), (I-749)+(1.092)+(7.004), (I-749)+(1.092)+(7.005), (I-749)+(1.092)+(7.006), (I-749)+(1.092)+(9.001), (I-749)+(1.092)+(9.002), (I-749)+(1.092)+(9.003), (I-749)+(1.092)+(9.004), (I-749)+(1.092)+(9.005), (I-749)+(1.092)+(9.006), (I-749)+(1.092)+(9.007), (I-749)+(1.092)+(9.008), (I-749)+(1.092)+(9.009), (I-749)+(1.092)+(14.001), (I-749)+(1.092)+(14.002), (I-749)+(1.092)+(15.008), (I-749)+(1.092)+(15.011), (I-749)+(1.092)+(15.012), (I-749)+(1.092)+(15.016), (I-749)+(1.092)+(15.025), (I-749)+(1.092)+(15.027), (I-749)+(1.092)+(15.047), (I-749)+(1.092)+(15.063), (I-749)+(1.092)+(15.064), (I-749)+(1.092)+(16.001), (I-749)+(1.092)+(16.002), (I-749)+(1.092)+(16.003), (I-749)+(1.092)+(16.004), (I-749)+(1.092)+(16.005), (I-749)+(1.092)+(16.006), (I-749)+(1.092)+(16.007), (I-749)+(1.092)+(16.008), (I-749)+(1.092)+(17.001), (I-749)+(1.092)+(17.002), (I-749)+(1.092)+(17.003), (I-749)+(1.092)+(17.004), (I-749)+(1.092)+(17.005), (I-749)+(1.092)+(17.006), (I-749)+(1.092)+(17.007), (I-749)+(1.092)+(17.008), (I-749)+(1.092)+(17.009), (I-749)+(1.092)+(17.010), (I-749)+(1.092)+(17.011), (I-749)+(1.092)+(17.012), (I-749)+(1.092)+(18.001),

(I-749)+(2.001)+(3.001), (I-749)+(2.001)+(3.002), (I-749)+(2.001)+(3.003), (I-749)+(2.001)+(3.004), (I-749)+(2.001)+(3.005), (I-749)+(2.001)+(3.006), (I-749)+(2.001)+(3.007), (I-749)+(2.001)+(3.008), (I-749)+(2.001)+(3.009), (I-749)+(2.001)+(3.010), (I-749)+(2.001)+(3.011), (I-749)+(2.001)+(3.012), (I-749)+(2.001)+(3.013), (I-749)+(2.001)+(3.014), (I-749)+(2.001)+(3.015), (I-749)+(2.001)+(3.016), (I-749)+(2.001)+(3.017), (I-749)+(2.001)+(3.018), (I-749)+(2.001)+(3.019), (I-749)+(2.001)+(3.020), (I-749)+(2.001)+(3.021), (I-749)+(2.001)+(3.022), (I-749)+(2.001)+(3.023), (I-749)+(2.001)+(3.024), (I-749)+(2.001)+(3.025), (I-749)+(2.001)+(3.026), (I-749)+(2.001)+(3.027), (I-749)+(2.001)+(3.028), (I-749)+(2.001)+(3.029), (I-749)+(2.001)+(3.030), (I-749)+(2.001)+(3.031), (I-749)+(2.001)+(5.001), (I-749)+(2.001)+(5.002), (I-749)+(2.001)+(5.003), (I-749)+(2.001)+(5.004), (I-749)+(2.001)+(5.005), (I-749)+(2.001)+(5.006), (I-749)+(2.001)+(5.007), (I-749)+(2.001)+(5.008), (I-749)+(2.001)+(5.009), (I-749)+(2.001)+(5.010), (I-749)+(2.001)+(5.011), (I-749)+(2.001)+(5.012), (I-749)+(2.001)+(5.013), (I-749)+(2.001)+(5.014), (I-749)+(2.001)+(5.015), (I-749)+(2.001)+(5.016), (I-749)+(2.001)+(5.017), (I-749)+(2.001)+(5.018), (I-749)+(2.001)+(5.019), (I-749)+(2.001)+(5.020), (I-749)+(2.001)+(5.021), (I-749)+(2.001)+(5.022), (I-749)+(2.001)+(5.023), (I-749)+(2.001)+(6.001), (I-749)+(2.001)+(6.002), (I-749)+(2.001)+(6.003), (I-749)+(2.001)+(6.004), (I-749)+(2.001)+(7.001), (I-749)+(2.001)+(7.002), (I-749)+(2.001)+(7.003), (I-749)+(2.001)+(7.004), (I-749)+(2.001)+(7.005), (I-749)+(2.001)+(7.006), (I-749)+(2.001)+(9.001), (I-749)+(2.001)+(9.002), (I-749)+(2.001)+(9.003), (I-749)+(2.001)+(9.004), (I-749)+(2.001)+(9.005), (I-749)+(2.001)+(9.006), (I-749)+(2.001)+(9.007), (I-749)+(2.001)+(9.008), (I-749)+(2.001)+(9.009), (I-749)+(2.001)+(14.001), (I-749)+(2.001)+(14.002), (I-749)+(2.001)+(15.008), (I-749)+(2.001)+(15.011), (I-749)+(2.001)+(15.012), (I-749)+(2.001)+(15.016), (I-749)+(2.001)+(15.025), (I-749)+(2.001)+(15.027), (I-749)+(2.001)+(15.047), (I-749)+(2.001)+(15.063), (I-749)+(2.001)+(15.064), (I-749)+(2.001)+(16.001), (I-749)+(2.001)+(16.002), (I-749)+(2.001)+(16.003), (I-749)+(2.001)+(16.004), (I-749)+(2.001)+(16.005), (I-749)+(2.001)+(16.006), (I-749)+(2.001)+(16.007), (I-749)+(2.001)+(16.008), (I-749)+(2.001)+(17.001), (I-749)+(2.001)+(17.002), (I-749)+(2.001)+(17.003), (I-749)+(2.001)+(17.004), (I-749)+(2.001)+(17.005), (I-749)+(2.001)+(17.006), (I-749)+(2.001)+(17.007), (I-749)+(2.001)+(17.008), (I-749)+(2.001)+(17.009), (I-749)+(2.001)+(17.010), (I-749)+(2.001)+(17.011), (I-749)+(2.001)+(17.012), (I-749)+(2.001)+(18.001),

(I-749)+(2.002)+(3.001), (I-749)+(2.002)+(3.002), (I-749)+(2.002)+(3.003), (I-749)+(2.002)+(3.004), (I-749)+(2.002)+(3.005), (I-749)+(2.002)+(3.006), (I-749)+(2.002)+(3.007), (I-749)+(2.002)+(3.008), (I-749)+(2.002)+(3.009), (I-749)+(2.002)+(3.010), (I-749)+(2.002)+(3.011), (I-749)+(2.002)+(3.012), (I-749)+(2.002)+(3.013), (I-749)+(2.002)+(3.014), (I-749)+(2.002)+(3.015), (I-749)+(2.002)+(3.016), (I-749)+(2.002)+(3.017), (I-749)+(2.002)+(3.018), (I-749)+(2.002)+(3.019), (I-749)+(2.002)+(3.020), (I-749)+(2.002)+(3.021), (I-749)+(2.002)+(3.022), (I-749)+(2.002)+(3.023), (I-749)+(2.002)+(3.024), (I-749)+(2.002)+(3.025), (I-749)+(2.002)+(3.026), (I-749)+(2.002)+(3.027), (I-749)+(2.002)+(3.028), (I-749)+(2.002)+(3.029), (I-749)+(2.002)+(3.030), (I-749)+(2.002)+(3.031), (I-749)+(2.002)+(5.001), (I-749)+(2.002)+(5.002), (I-749)+(2.002)+(5.003), (I-749)+(2.002)+(5.004), (I-749)+(2.002)+(5.005), (I-749)+(2.002)+(5.006), (I-749)+(2.002)+(5.007), (I-749)+(2.002)+(5.008), (I-749)+(2.002)+(5.009), (I-749)+(2.002)+(5.010), (I-749)+(2.002)+(5.011), (I-749)+(2.002)+(5.012), (I-749)+(2.002)+(5.013), (I-749)+(2.002)+(5.014), (I-749)+(2.002)+(5.015), (I-749)+(2.002)+(5.016), (I-749)+(2.002)+(5.017), (I-749)+(2.002)+(5.018), (I-749)+(2.002)+(5.019), (I-749)+(2.002)+(5.020), (I-749)+(2.002)+(5.021), (I-749)+(2.002)+(5.022), (I-749)+(2.002)+(5.023), (I-749)+(2.002)+(6.001), (I-749)+(2.002)+(6.002), (I-749)+(2.002)+(6.003), (I-749)+(2.002)+(6.004), (I-749)+(2.002)+(7.001), (I-749)+(2.002)+(7.002), (I-749)+(2.002)+(7.003), (I-749)+(2.002)+(7.004), (I-749)+(2.002)+(7.005), (I-749)+(2.002)+(7.006), (I-749)+(2.002)+(9.001), (I-749)+(2.002)+(9.002), (I-749)+(2.002)+(9.003), (I-749)+(2.002)+(9.004), (I-749)+(2.002)+(9.005), (I-749)+(2.002)+(9.006), (I-749)+(2.002)+(9.007), (I-749)+(2.002)+(9.008), (I-749)+(2.002)+(9.009), (I-749)+(2.002)+(14.001), (I-749)+(2.002)+(14.002), (I-749)+(2.002)+(15.008), (I-749)+(2.002)+(15.011), (I-749)+(2.002)+(15.012), (I-749)+(2.002)+(15.016), (I-749)+(2.002)+(15.025), (I-749)+(2.002)+(15.027), (I-749)+(2.002)+(15.047), (I-749)+(2.002)+(15.063), (I-749)+(2.002)+(15.064), (I-749)+(2.002)+(16.001), (I-749)+(2.002)+(16.002), (I-749)+(2.002)+(16.003), (I-749)+(2.002)+(16.004), (I-749)+(2.002)+(16.005), (I-749)+(2.002)+(16.006), (I-749)+(2.002)+(16.007), (I-749)+(2.002)+(16.008), (I-749)+(2.002)+(17.001), (I-749)+(2.002)+(17.002), (I-749)+(2.002)+(17.003), (I-749)+(2.002)+(17.004), (I-749)+(2.002)+(17.005), (I-749)+(2.002)+(17.006), (I-749)+(2.002)+(17.007), (I-749)+(2.002)+(17.008), (I-749)+(2.002)+(17.009), (I-749)+(2.002)+(17.010), (I-749)+(2.002)+(17.011), (I-749)+(2.002)+(17.012), (I-749)+(2.002)+(18.001),

(I-749)+(2.003)+(3.001), (I-749)+(2.003)+(3.002), (I-749)+(2.003)+(3.003), (I-749)+(2.003)+(3.004), (I-749)+(2.003)+(3.005), (I-749)+(2.003)+(3.006), (I-749)+(2.003)+(3.007), (I-749)+(2.003)+(3.008), (I-749)+(2.003)+(3.009), (I-749)+(2.003)+(3.010), (I-749)+(2.003)+(3.011), (I-749)+(2.003)+(3.012), (I-749)+(2.003)+(3.013), (I-749)+(2.003)+(3.014), (I-749)+(2.003)+(3.015), (I-749)+(2.003)+(3.016), (I-749)+(2.003)+(3.017), (I-749)+(2.003)+(3.018), (I-749)+(2.003)+(3.019), (I-749)+(2.003)+(3.020), (I-749)+(2.003)+(3.021), (I-749)+(2.003)+(3.022), (I-749)+(2.003)+(3.023), (I-749)+(2.003)+(3.024), (I-749)+(2.003)+(3.025), (I-749)+(2.003)+(3.026), (I-749)+(2.003)+(3.027), (I-749)+(2.003)+(3.028), (I-749)+(2.003)+(3.029), (I-749)+(2.003)+(3.030), (I-749)+(2.003)+(3.031), (I-749)+(2.003)+(5.001), (I-749)+(2.003)+(5.002), (I-749)+(2.003)+(5.003), (I-749)+(2.003)+(5.004), (I-749)+(2.003)+(5.005), (I-749)+(2.003)+(5.006), (I-749)+(2.003)+(5.007), (I-749)+(2.003)+(5.008), (I-749)+(2.003)+(5.009), (I-749)+(2.003)+(5.010), (I-749)+(2.003)+(5.011), (I-749)+(2.003)+(5.012), (I-749)+(2.003)+(5.013), (I-749)+(2.003)+(5.014), (I-749)+(2.003)+(5.015), (I-749)+(2.003)+(5.016), (I-749)+(2.003)+(5.017), (I-749)+(2.003)+(5.018), (I-749)+(2.003)+(5.019), (I-749)+(2.003)+(5.020), (I-749)+(2.003)+(5.021), (I-749)+(2.003)+(5.022), (I-749)+(2.003)+(5.023), (I-749)+(2.003)+(6.001), (I-749)+(2.003)+(6.002), (I-749)+(2.003)+(6.003), (I-749)+(2.003)+(6.004), (I-749)+(2.003)+(7.001), (I-749)+(2.003)+(7.002), (I-749)+(2.003)+(7.003), (I-749)+(2.003)+(7.004), (I-749)+(2.003)+(7.005), (I-749)+(2.003)+(7.006), (I-749)+(2.003)+(9.001), (I-749)+(2.003)+(9.002), (I-749)+(2.003)+(9.003), (I-749)+(2.003)+(9.004), (I-749)+(2.003)+(9.005), (I-749)+(2.003)+(9.006), (I-749)+(2.003)+(9.007), (I-749)+(2.003)+(9.008), (I-749)+(2.003)+(9.009), (I-749)+(2.003)+(14.001), (I-749)+(2.003)+(14.002), (I-749)+(2.003)+(15.008), (I-749)+(2.003)+(15.011), (I-749)+(2.003)+(15.012), (I-749)+(2.003)+(15.016), (I-749)+(2.003)+(15.025), (I-749)+(2.003)+(15.027), (I-749)+(2.003)+(15.047), (I-749)+(2.003)+(15.063), (I-749)+(2.003)+(15.064), (I-749)+(2.003)+(16.001), (I-749)+(2.003)+(16.002), (I-749)+(2.003)+(16.003), (I-749)+(2.003)+(16.004), (I-749)+(2.003)+(16.005), (I-749)+(2.003)+(16.006), (I-749)+(2.003)+(16.007), (I-749)+(2.003)+(16.008), (I-749)+(2.003)+(17.001), (I-749)+(2.003)+(17.002), (I-749)+(2.003)+(17.003), (I-749)+(2.003)+(17.004), (I-749)+(2.003)+(17.005), (I-749)+(2.003)+(17.006), (I-749)+(2.003)+(17.007), (I-749)+(2.003)+(17.008), (I-749)+(2.003)+(17.009), (I-749)+(2.003)+(17.010), (I-749)+(2.003)+(17.011), (I-749)+(2.003)+(17.012), (I-749)+(2.003)+(18.001),

(I-749)+(2.004)+(3.001), (I-749)+(2.004)+(3.002), (I-749)+(2.004)+(3.003), (I-749)+(2.004)+(3.004), (I-749)+(2.004)+(3.005), (I-749)+(2.004)+(3.006), (I-749)+(2.004)+(3.007), (I-749)+(2.004)+(3.008), (I-749)+(2.004)+(3.009), (I-749)+(2.004)+(3.010), (I-749)+(2.004)+(3.011), (I-749)+(2.004)+(3.012), (I-749)+(2.004)+(3.013), (I-749)+(2.004)+(3.014), (I-749)+(2.004)+(3.015), (I-749)+(2.004)+(3.016), (I-749)+(2.004)+(3.017), (I-749)+(2.004)+(3.018), (I-749)+(2.004)+(3.019), (I-749)+(2.004)+(3.020), (I-749)+(2.004)+(3.021), (I-749)+(2.004)+(3.022), (I-749)+(2.004)+(3.023), (I-749)+(2.004)+(3.024), (I-749)+(2.004)+(3.025), (I-749)+(2.004)+(3.026), (I-749)+(2.004)+(3.027), (I-749)+(2.004)+(3.028), (I-749)+(2.004)+(3.029), (I-749)+(2.004)+(3.030), (I-749)+(2.004)+(3.031), (I-749)+(2.004)+(5.001), (I-749)+(2.004)+(5.002), (I-749)+(2.004)+(5.003), (I-749)+(2.004)+(5.004), (I-749)+(2.004)+(5.005), (I-749)+(2.004)+(5.006), (I-749)+(2.004)+(5.007), (I-749)+(2.004)+(5.008), (I-749)+(2.004)+(5.009), (I-749)+(2.004)+(5.010), (I-749)+(2.004)+(5.011), (I-749)+(2.004)+(5.012), (I-749)+(2.004)+(5.013), (I-749)+(2.004)+(5.014), (I-749)+(2.004)+(5.015), (I-749)+(2.004)+(5.016), (I-749)+(2.004)+(5.017), (I-749)+(2.004)+(5.018), (I-749)+(2.004)+(5.019), (I-749)+(2.004)+(5.020), (I-749)+(2.004)+(5.021), (I-749)+(2.004)+(5.022), (I-749)+(2.004)+(5.023), (I-749)+(2.004)+(6.001), (I-749)+(2.004)+(6.002), (I-749)+(2.004)+(6.003), (I-749)+(2.004)+(6.004), (I-749)+(2.004)+(7.001), (I-749)+(2.004)+(7.002), (I-749)+(2.004)+(7.003), (I-749)+(2.004)+(7.004), (I-749)+(2.004)+(7.005), (I-749)+(2.004)+(7.006), (I-749)+(2.004)+(9.001), (I-749)+(2.004)+(9.002), (I-749)+(2.004)+(9.003), (I-749)+(2.004)+(9.004), (I-749)+(2.004)+(9.005), (I-749)+(2.004)+(9.006), (I-749)+(2.004)+(9.007), (I-749)+(2.004)+(9.008), (I-749)+(2.004)+(9.009), (I-749)+(2.004)+(14.001), (I-749)+(2.004)+(14.002), (I-749)+(2.004)+(15.008), (I-749)+(2.004)+(15.011), (I-749)+(2.004)+(15.012), (I-749)+(2.004)+(15.016), (I-749)+(2.004)+(15.025), (I-749)+(2.004)+(15.027), (I-749)+(2.004)+(15.047), (I-749)+(2.004)+(15.063), (I-749)+(2.004)+(15.064), (I-749)+(2.004)+(16.001), (I-749)+(2.004)+(16.002), (I-749)+(2.004)+(16.003), (I-749)+(2.004)+(16.004), (I-749)+(2.004)+(16.005), (I-749)+(2.004)+(16.006), (I-749)+(2.004)+(16.007), (I-749)+(2.004)+(16.008), (I-749)+(2.004)+(17.001), (I-749)+(2.004)+(17.002), (I-749)+(2.004)+(17.003), (I-749)+(2.004)+(17.004), (I-749)+(2.004)+(17.005), (I-749)+(2.004)+(17.006), (I-749)+(2.004)+(17.007), (I-749)+(2.004)+(17.008), (I-749)+(2.004)+(17.009), (I-749)+(2.004)+(17.010), (I-749)+(2.004)+(17.011), (I-749)+(2.004)+(17.012), (I-749)+(2.004)+(18.001),

(I-749)+(2.005)+(3.001), (I-749)+(2.005)+(3.002), (I-749)+(2.005)+(3.003), (I-749)+(2.005)+(3.004), (I-749)+(2.005)+(3.005), (I-749)+(2.005)+(3.006), (I-749)+(2.005)+(3.007), (I-749)+(2.005)+(3.008), (I-749)+(2.005)+(3.009), (I-749)+(2.005)+(3.010), (I-749)+(2.005)+(3.011), (I-749)+(2.005)+(3.012), (I-749)+(2.005)+(3.013), (I-749)+(2.005)+(3.014), (I-749)+(2.005)+(3.015), (I-749)+(2.005)+(3.016), (I-749)+(2.005)+(3.017), (I-749)+(2.005)+(3.018), (I-749)+(2.005)+(3.019), (I-749)+(2.005)+(3.020), (I-749)+(2.005)+(3.021), (I-749)+(2.005)+(3.022), (I-749)+(2.005)+(3.023), (I-749)+(2.005)+(3.024), (I-749)+(2.005)+(3.025), (I-749)+(2.005)+(3.026), (I-749)+(2.005)+(3.027), (I-749)+(2.005)+(3.028), (I-749)+(2.005)+(3.029), (I-749)+(2.005)+(3.030), (I-749)+(2.005)+(3.031), (I-749)+(2.005)+(5.001), (I-749)+(2.005)+(5.002), (I-749)+(2.005)+(5.003), (I-749)+(2.005)+(5.004), (I-749)+(2.005)+(5.005), (I-749)+(2.005)+(5.006), (I-749)+(2.005)+(5.007), (I-749)+(2.005)+(5.008), (I-749)+(2.005)+(5.009), (I-749)+(2.005)+(5.010), (I-749)+(2.005)+(5.011), (I-749)+(2.005)+(5.012), (I-749)+(2.005)+(5.013), (I-749)+(2.005)+(5.014), (I-749)+(2.005)+(5.015), (I-749)+(2.005)+(5.016), (I-749)+(2.005)+(5.017), (I-749)+(2.005)+(5.018), (I-749)+(2.005)+(5.019), (I-749)+(2.005)+(5.020), (I-749)+(2.005)+(5.021), (I-749)+(2.005)+(5.022), (I-749)+(2.005)+(5.023), (I-749)+(2.005)+(6.001), (I-749)+(2.005)+(6.002), (I-749)+(2.005)+(6.003), (I-749)+(2.005)+(6.004), (I-749)+(2.005)+(7.001), (I-749)+(2.005)+(7.002), (I-749)+(2.005)+(7.003), (I-749)+(2.005)+(7.004), (I-749)+(2.005)+(7.005), (I-749)+(2.005)+(7.006), (I-749)+(2.005)+(9.001), (I-749)+(2.005)+(9.002), (I-749)+(2.005)+(9.003), (I-749)+(2.005)+(9.004), (I-749)+(2.005)+(9.005), (I-749)+(2.005)+(9.006), (I-749)+(2.005)+(9.007), (I-749)+(2.005)+(9.008), (I-749)+(2.005)+(9.009), (I-749)+(2.005)+(14.001), (I-749)+(2.005)+(14.002), (I-749)+(2.005)+(15.008), (I-749)+(2.005)+(15.011), (I-749)+(2.005)+(15.012), (I-749)+(2.005)+(15.016), (I-749)+(2.005)+(15.025), (I-749)+(2.005)+(15.027), (I-749)+(2.005)+(15.047), (I-749)+(2.005)+(15.063), (I-749)+(2.005)+(15.064), (I-749)+(2.005)+(16.001), (I-749)+(2.005)+(16.002), (I-749)+(2.005)+(16.003), (I-749)+(2.005)+(16.004), (I-749)+(2.005)+(16.005), (I-749)+(2.005)+(16.006), (I-749)+(2.005)+(16.007), (I-749)+(2.005)+(16.008), (I-749)+(2.005)+(17.001), (I-749)+(2.005)+(17.002), (I-749)+(2.005)+(17.003), (I-749)+(2.005)+(17.004), (I-749)+(2.005)+(17.005), (I-749)+(2.005)+(17.006), (I-749)+(2.005)+(17.007), (I-749)+(2.005)+(17.008), (I-749)+(2.005)+(17.009), (I-749)+(2.005)+(17.010), (I-749)+(2.005)+(17.011), (I-749)+(2.005)+(17.012), (I-749)+(2.005)+(18.001),

(I-749)+(2.006)+(3.001), (I-749)+(2.006)+(3.002), (I-749)+(2.006)+(3.003), (I-749)+(2.006)+(3.004), (I-749)+(2.006)+(3.005), (I-749)+(2.006)+(3.006), (I-749)+(2.006)+(3.007), (I-749)+(2.006)+(3.008), (I-749)+(2.006)+(3.009), (I-749)+(2.006)+(3.010), (I-749)+(2.006)+(3.011), (I-749)+(2.006)+(3.012), (I-749)+(2.006)+(3.013), (I-749)+(2.006)+(3.014), (I-749)+(2.006)+(3.015), (I-749)+(2.006)+(3.016), (I-749)+(2.006)+(3.017), (I-749)+(2.006)+(3.018), (I-749)+(2.006)+(3.019), (I-749)+(2.006)+(3.020), (I-749)+(2.006)+(3.021), (I-749)+(2.006)+(3.022), (I-749)+(2.006)+(3.023), (I-749)+(2.006)+(3.024), (I-749)+(2.006)+(3.025), (I-749)+(2.006)+(3.026), (I-749)+(2.006)+(3.027), (I-749)+(2.006)+(3.028), (I-749)+(2.006)+(3.029), (I-749)+(2.006)+(3.030), (I-749)+(2.006)+(3.031), (I-749)+(2.006)+(5.001), (I-749)+(2.006)+(5.002), (I-749)+(2.006)+(5.003), (I-749)+(2.006)+(5.004), (I-749)+(2.006)+(5.005), (I-749)+(2.006)+(5.006), (I-749)+(2.006)+(5.007), (I-749)+(2.006)+(5.008), (I-749)+(2.006)+(5.009), (I-749)+(2.006)+(5.010), (I-749)+(2.006)+(5.011), (I-749)+(2.006)+(5.012), (I-749)+(2.006)+(5.013), (I-749)+(2.006)+(5.014), (I-749)+(2.006)+(5.015), (I-749)+(2.006)+(5.016), (I-749)+(2.006)+(5.017), (I-749)+(2.006)+(5.018), (I-749)+(2.006)+(5.019), (I-749)+(2.006)+(5.020), (I-749)+(2.006)+(5.021), (I-749)+(2.006)+(5.022), (I-749)+(2.006)+(5.023), (I-749)+(2.006)+(6.001), (I-749)+(2.006)+(6.002), (I-749)+(2.006)+(6.003), (I-749)+(2.006)+(6.004), (I-749)+(2.006)+(7.001), (I-749)+(2.006)+(7.002), (I-749)+(2.006)+(7.003), (I-749)+(2.006)+(7.004), (I-749)+(2.006)+(7.005), (I-749)+(2.006)+(7.006), (I-749)+(2.006)+(9.001), (I-749)+(2.006)+(9.002), (I-749)+(2.006)+(9.003), (I-749)+(2.006)+(9.004), (I-749)+(2.006)+(9.005), (I-749)+(2.006)+(9.006), (I-749)+(2.006)+(9.007), (I-749)+(2.006)+(9.008), (I-749)+(2.006)+(9.009), (I-749)+(2.006)+(14.001), (I-749)+(2.006)+(14.002), (I-749)+(2.006)+(15.008), (I-749)+(2.006)+(15.011), (I-749)+(2.006)+(15.012), (I-749)+(2.006)+(15.016), (I-749)+(2.006)+(15.025), (I-749)+(2.006)+(15.027), (I-749)+(2.006)+(15.047), (I-749)+(2.006)+(15.063), (I-749)+(2.006)+(15.064), (I-749)+(2.006)+(16.001), (I-749)+(2.006)+(16.002), (I-749)+(2.006)+(16.003), (I-749)+(2.006)+(16.004), (I-749)+(2.006)+(16.005), (I-749)+(2.006)+(16.006), (I-749)+(2.006)+(16.007), (I-749)+(2.006)+(16.008), (I-749)+(2.006)+(17.001), (I-749)+(2.006)+(17.002), (I-749)+(2.006)+(17.003), (I-749)+(2.006)+(17.004), (I-749)+(2.006)+(17.005), (I-749)+(2.006)+(17.006), (I-749)+(2.006)+(17.007), (I-749)+(2.006)+(17.008), (I-749)+(2.006)+(17.009), (I-749)+(2.006)+(17.010), (I-749)+(2.006)+(17.011), (I-749)+(2.006)+(17.012), (I-749)+(2.006)+(18.001),

(I-749)+(2.007)+(3.001), (I-749)+(2.007)+(3.002), (I-749)+(2.007)+(3.003), (I-749)+(2.007)+(3.004), (I-749)+(2.007)+(3.005), (I-749)+(2.007)+(3.006), (I-749)+(2.007)+(3.007), (I-749)+(2.007)+(3.008), (I-749)+(2.007)+(3.009), (I-749)+(2.007)+(3.010), (I-749)+(2.007)+(3.011), (I-749)+(2.007)+(3.012), (I-749)+(2.007)+(3.013), (I-749)+(2.007)+(3.014), (I-749)+(2.007)+(3.015), (I-749)+(2.007)+(3.016), (I-749)+(2.007)+(3.017), (I-749)+(2.007)+(3.018), (I-749)+(2.007)+(3.019), (I-749)+(2.007)+(3.020), (I-749)+(2.007)+(3.021), (I-749)+(2.007)+(3.022), (I-749)+(2.007)+(3.023), (I-749)+(2.007)+(3.024), (I-749)+(2.007)+(3.025), (I-749)+(2.007)+(3.026), (I-749)+(2.007)+(3.027), (I-749)+(2.007)+(3.028), (I-749)+(2.007)+(3.029), (I-749)+(2.007)+(3.030), (I-749)+(2.007)+(3.031), (I-749)+(2.007)+(5.001), (I-749)+(2.007)+(5.002), (I-749)+(2.007)+(5.003), (I-749)+(2.007)+(5.004), (I-749)+(2.007)+(5.005), (I-749)+(2.007)+(5.006), (I-749)+(2.007)+(5.007), (I-749)+(2.007)+(5.008), (I-749)+(2.007)+(5.009), (I-749)+(2.007)+(5.010), (I-749)+(2.007)+(5.011), (I-749)+(2.007)+(5.012), (I-749)+(2.007)+(5.013), (I-749)+(2.007)+(5.014), (I-749)+(2.007)+(5.015), (I-749)+(2.007)+(5.016), (I-749)+(2.007)+(5.017), (I-749)+(2.007)+(5.018), (I-749)+(2.007)+(5.019), (I-749)+(2.007)+(5.020), (I-749)+(2.007)+(5.021), (I-749)+(2.007)+(5.022), (I-749)+(2.007)+(5.023), (I-749)+(2.007)+(6.001), (I-749)+(2.007)+(6.002), (I-749)+(2.007)+(6.003), (I-749)+(2.007)+(6.004), (I-749)+(2.007)+(7.001), (I-749)+(2.007)+(7.002), (I-749)+(2.007)+(7.003), (I-749)+(2.007)+(7.004), (I-749)+(2.007)+(7.005), (I-749)+(2.007)+(7.006), (I-749)+(2.007)+(9.001), (I-749)+(2.007)+(9.002), (I-749)+(2.007)+(9.003), (I-749)+(2.007)+(9.004), (I-749)+(2.007)+(9.005), (I-749)+(2.007)+(9.006), (I-749)+(2.007)+(9.007), (I-749)+(2.007)+(9.008), (I-749)+(2.007)+(9.009), (I-749)+(2.007)+(14.001), (I-749)+(2.007)+(14.002), (I-749)+(2.007)+(15.008), (I-749)+(2.007)+(15.011), (I-749)+(2.007)+(15.012), (I-749)+(2.007)+(15.016), (I-749)+(2.007)+(15.025), (I-749)+(2.007)+(15.027), (I-749)+(2.007)+(15.047), (I-749)+(2.007)+(15.063), (I-749)+(2.007)+(15.064), (I-749)+(2.007)+(16.001), (I-749)+(2.007)+(16.002), (I-749)+(2.007)+(16.003), (I-749)+(2.007)+(16.004), (I-749)+(2.007)+(16.005), (I-749)+(2.007)+(16.006), (I-749)+(2.007)+(16.007), (I-749)+(2.007)+(16.008), (I-749)+(2.007)+(17.001), (I-749)+(2.007)+(17.002), (I-749)+(2.007)+(17.003), (I-749)+(2.007)+(17.004), (I-749)+(2.007)+(17.005), (I-749)+(2.007)+(17.006), (I-749)+(2.007)+(17.007), (I-749)+(2.007)+(17.008), (I-749)+(2.007)+(17.009), (I-749)+(2.007)+(17.010), (I-749)+(2.007)+(17.011), (I-749)+(2.007)+(17.012), (I-749)+(2.007)+(18.001),

(I-749)+(2.008)+(3.001), (I-749)+(2.008)+(3.002), (I-749)+(2.008)+(3.003), (I-749)+(2.008)+(3.004), (I-749)+(2.008)+(3.005), (I-749)+(2.008)+(3.006), (I-749)+(2.008)+(3.007), (I-749)+(2.008)+(3.008), (I-749)+(2.008)+(3.009), (I-749)+(2.008)+(3.010), (I-749)+(2.008)+(3.011), (I-749)+(2.008)+(3.012), (I-749)+(2.008)+(3.013), (I-749)+(2.008)+(3.014), (I-749)+(2.008)+(3.015), (I-749)+(2.008)+(3.016), (I-749)+(2.008)+(3.017), (I-749)+(2.008)+(3.018), (I-749)+(2.008)+(3.019), (I-749)+(2.008)+(3.020), (I-749)+(2.008)+(3.021), (I-749)+(2.008)+(3.022), (I-749)+(2.008)+(3.023), (I-749)+(2.008)+(3.024), (I-749)+(2.008)+(3.025), (I-749)+(2.008)+(3.026), (I-749)+(2.008)+(3.027), (I-749)+(2.008)+(3.028), (I-749)+(2.008)+(3.029), (I-749)+(2.008)+(3.030), (I-749)+(2.008)+(3.031), (I-749)+(2.008)+(5.001), (I-749)+(2.008)+(5.002), (I-749)+(2.008)+(5.003), (I-749)+(2.008)+(5.004), (I-749)+(2.008)+(5.005), (I-749)+(2.008)+(5.006), (I-749)+(2.008)+(5.007), (I-749)+(2.008)+(5.008), (I-749)+(2.008)+(5.009), (I-749)+(2.008)+(5.010), (I-749)+(2.008)+(5.011), (I-749)+(2.008)+(5.012), (I-749)+(2.008)+(5.013), (I-749)+(2.008)+(5.014), (I-749)+(2.008)+(5.015), (I-749)+(2.008)+(5.016), (I-749)+(2.008)+(5.017), (I-749)+(2.008)+(5.018), (I-749)+(2.008)+(5.019), (I-749)+(2.008)+(5.020), (I-749)+(2.008)+(5.021), (I-749)+(2.008)+(5.022), (I-749)+(2.008)+(5.023), (I-749)+(2.008)+(6.001), (I-749)+(2.008)+(6.002), (I-749)+(2.008)+(6.003), (I-749)+(2.008)+(6.004), (I-749)+(2.008)+(7.001), (I-749)+(2.008)+(7.002), (I-749)+(2.008)+(7.003), (I-749)+(2.008)+(7.004), (I-749)+(2.008)+(7.005), (I-749)+(2.008)+(7.006), (I-749)+(2.008)+(9.001), (I-749)+(2.008)+(9.002), (I-749)+(2.008)+(9.003), (I-749)+(2.008)+(9.004), (I-749)+(2.008)+(9.005), (I-749)+(2.008)+(9.006), (I-749)+(2.008)+(9.007), (I-749)+(2.008)+(9.008), (I-749)+(2.008)+(9.009), (I-749)+(2.008)+(14.001), (I-749)+(2.008)+(14.002), (I-749)+(2.008)+(15.008), (I-749)+(2.008)+(15.011), (I-749)+(2.008)+(15.012), (I-749)+(2.008)+(15.016), (I-749)+(2.008)+(15.025), (I-749)+(2.008)+(15.027), (I-749)+(2.008)+(15.047), (I-749)+(2.008)+(15.063), (I-749)+(2.008)+(15.064), (I-749)+(2.008)+(16.001), (I-749)+(2.008)+(16.002), (I-749)+(2.008)+(16.003), (I-749)+(2.008)+(16.004), (I-749)+(2.008)+(16.005), (I-749)+(2.008)+(16.006), (I-749)+(2.008)+(16.007), (I-749)+(2.008)+(16.008), (I-749)+(2.008)+(17.001), (I-749)+(2.008)+(17.002), (I-749)+(2.008)+(17.003), (I-749)+(2.008)+(17.004), (I-749)+(2.008)+(17.005), (I-749)+(2.008)+(17.006), (I-749)+(2.008)+(17.007), (I-749)+(2.008)+(17.008), (I-749)+(2.008)+(17.009), (I-749)+(2.008)+(17.010), (I-749)+(2.008)+(17.011), (I-749)+(2.008)+(17.012), (I-749)+(2.008)+(18.001),

(I-749)+(2.009)+(3.001), (I-749)+(2.009)+(3.002), (I-749)+(2.009)+(3.003), (I-749)+(2.009)+(3.004), (I-749)+(2.009)+(3.005), (I-749)+(2.009)+(3.006), (I-749)+(2.009)+(3.007), (I-749)+(2.009)+(3.008), (I-749)+(2.009)+(3.009), (I-749)+(2.009)+(3.010), (I-749)+(2.009)+(3.011), (I-749)+(2.009)+(3.012), (I-749)+(2.009)+(3.013), (I-749)+(2.009)+(3.014), (I-749)+(2.009)+(3.015), (I-749)+(2.009)+(3.016), (I-749)+(2.009)+(3.017), (I-749)+(2.009)+(3.018), (I-749)+(2.009)+(3.019), (I-749)+(2.009)+(3.020), (I-749)+(2.009)+(3.021), (I-749)+(2.009)+(3.022), (I-749)+(2.009)+(3.023), (I-749)+(2.009)+(3.024), (I-749)+(2.009)+(3.025), (I-749)+(2.009)+(3.026), (I-749)+(2.009)+(3.027), (I-749)+(2.009)+(3.028), (I-749)+(2.009)+(3.029), (I-749)+(2.009)+(3.030), (I-749)+(2.009)+(3.031), (I-749)+(2.009)+(5.001), (I-749)+(2.009)+(5.002), (I-749)+(2.009)+(5.003), (I-749)+(2.009)+(5.004), (I-749)+(2.009)+(5.005), (I-749)+(2.009)+(5.006), (I-749)+(2.009)+(5.007), (I-749)+(2.009)+(5.008), (I-749)+(2.009)+(5.009), (I-749)+(2.009)+(5.010), (I-749)+(2.009)+(5.011), (I-749)+(2.009)+(5.012), (I-749)+(2.009)+(5.013), (I-749)+(2.009)+(5.014), (I-749)+(2.009)+(5.015), (I-749)+(2.009)+(5.016), (I-749)+(2.009)+(5.017), (I-749)+(2.009)+(5.018), (I-749)+(2.009)+(5.019), (I-749)+(2.009)+(5.020), (I-749)+(2.009)+(5.021), (I-749)+(2.009)+(5.022), (I-749)+(2.009)+(5.023), (I-749)+(2.009)+(6.001), (I-749)+(2.009)+(6.002), (I-749)+(2.009)+(6.003), (I-749)+(2.009)+(6.004), (I-749)+(2.009)+(7.001), (I-749)+(2.009)+(7.002), (I-749)+(2.009)+(7.003), (I-749)+(2.009)+(7.004), (I-749)+(2.009)+(7.005), (I-749)+(2.009)+(7.006), (I-749)+(2.009)+(9.001), (I-749)+(2.009)+(9.002), (I-749)+(2.009)+(9.003), (I-749)+(2.009)+(9.004), (I-749)+(2.009)+(9.005), (I-749)+(2.009)+(9.006), (I-749)+(2.009)+(9.007), (I-749)+(2.009)+(9.008), (I-749)+(2.009)+(9.009), (I-749)+(2.009)+(14.001), (I-749)+(2.009)+(14.002), (I-749)+(2.009)+(15.008), (I-749)+(2.009)+(15.011), (I-749)+(2.009)+(15.012), (I-749)+(2.009)+(15.016), (I-749)+(2.009)+(15.025), (I-749)+(2.009)+(15.027), (I-749)+(2.009)+(15.047), (I-749)+(2.009)+(15.063), (I-749)+(2.009)+(15.064), (I-749)+(2.009)+(16.001), (I-749)+(2.009)+(16.002), (I-749)+(2.009)+(16.003), (I-749)+(2.009)+(16.004), (I-749)+(2.009)+(16.005), (I-749)+(2.009)+(16.006), (I-749)+(2.009)+(16.007), (I-749)+(2.009)+(16.008), (I-749)+(2.009)+(17.001), (I-749)+(2.009)+(17.002), (I-749)+(2.009)+(17.003), (I-749)+(2.009)+(17.004), (I-749)+(2.009)+(17.005), (I-749)+(2.009)+(17.006), (I-749)+(2.009)+(17.007), (I-749)+(2.009)+(17.008), (I-749)+(2.009)+(17.009), (I-749)+(2.009)+(17.010), (I-749)+(2.009)+(17.011), (I-749)+(2.009)+(17.012), (I-749)+(2.009)+(18.001),

(I-749)+(2.010)+(3.001), (I-749)+(2.010)+(3.002), (I-749)+(2.010)+(3.003), (I-749)+(2.010)+(3.004), (I-749)+(2.010)+(3.005), (I-749)+(2.010)+(3.006), (I-749)+(2.010)+(3.007), (I-749)+(2.010)+(3.008), (I-749)+(2.010)+(3.009), (I-749)+(2.010)+(3.010), (I-749)+(2.010)+(3.011), (I-749)+(2.010)+(3.012), (I-749)+(2.010)+(3.013), (I-749)+(2.010)+(3.014), (I-749)+(2.010)+(3.015), (I-749)+(2.010)+(3.016), (I-749)+(2.010)+(3.017), (I-749)+(2.010)+(3.018), (I-749)+(2.010)+(3.019), (I-749)+(2.010)+(3.020), (I-749)+(2.010)+(3.021), (I-749)+(2.010)+(3.022), (I-749)+(2.010)+(3.023), (I-749)+(2.010)+(3.024), (I-749)+(2.010)+(3.025), (I-749)+(2.010)+(3.026), (I-749)+(2.010)+(3.027), (I-749)+(2.010)+(3.028), (I-749)+(2.010)+(3.029), (I-749)+(2.010)+(3.030), (I-749)+(2.010)+(3.031), (I-749)+(2.010)+(5.001), (I-749)+(2.010)+(5.002), (I-749)+(2.010)+(5.003), (I-749)+(2.010)+(5.004), (I-749)+(2.010)+(5.005), (I-749)+(2.010)+(5.006), (I-749)+(2.010)+(5.007), (I-749)+(2.010)+(5.008), (I-749)+(2.010)+(5.009), (I-749)+(2.010)+(5.010), (I-749)+(2.010)+(5.011), (I-749)+(2.010)+(5.012), (I-749)+(2.010)+(5.013), (I-749)+(2.010)+(5.014), (I-749)+(2.010)+(5.015), (I-749)+(2.010)+(5.016), (I-749)+(2.010)+(5.017), (I-749)+(2.010)+(5.018), (I-749)+(2.010)+(5.019), (I-749)+(2.010)+(5.020), (I-749)+(2.010)+(5.021), (I-749)+(2.010)+(5.022), (I-749)+(2.010)+(5.023), (I-749)+(2.010)+(6.001), (I-749)+(2.010)+(6.002), (I-749)+(2.010)+(6.003), (I-749)+(2.010)+(6.004), (I-749)+(2.010)+(7.001), (I-749)+(2.010)+(7.002), (I-749)+(2.010)+(7.003), (I-749)+(2.010)+(7.004), (I-749)+(2.010)+(7.005), (I-749)+(2.010)+(7.006), (I-749)+(2.010)+(9.001), (I-749)+(2.010)+(9.002), (I-749)+(2.010)+(9.003), (I-749)+(2.010)+(9.004), (I-749)+(2.010)+(9.005), (I-749)+(2.010)+(9.006), (I-749)+(2.010)+(9.007), (I-749)+(2.010)+(9.008), (I-749)+(2.010)+(9.009), (I-749)+(2.010)+(14.001), (I-749)+(2.010)+(14.002), (I-749)+(2.010)+(15.008), (I-749)+(2.010)+(15.011), (I-749)+(2.010)+(15.012), (I-749)+(2.010)+(15.016), (I-749)+(2.010)+(15.025), (I-749)+(2.010)+(15.027), (I-749)+(2.010)+(15.047), (I-749)+(2.010)+(15.063), (I-749)+(2.010)+(15.064), (I-749)+(2.010)+(16.001), (I-749)+(2.010)+(16.002), (I-749)+(2.010)+(16.003), (I-749)+(2.010)+(16.004), (I-749)+(2.010)+(16.005), (I-749)+(2.010)+(16.006), (I-749)+(2.010)+(16.007), (I-749)+(2.010)+(16.008), (I-749)+(2.010)+(17.001), (I-749)+(2.010)+(17.002), (I-749)+(2.010)+(17.003), (I-749)+(2.010)+(17.004), (I-749)+(2.010)+(17.005), (I-749)+(2.010)+(17.006), (I-749)+(2.010)+(17.007), (I-749)+(2.010)+(17.008), (I-749)+(2.010)+(17.009), (I-749)+(2.010)+(17.010), (I-749)+(2.010)+(17.011), (I-749)+(2.010)+(17.012), (I-749)+(2.010)+(18.001),

(I-749)+(2.011)+(3.001), (I-749)+(2.011)+(3.002), (I-749)+(2.011)+(3.003), (I-749)+(2.011)+(3.004), (I-749)+(2.011)+(3.005), (I-749)+(2.011)+(3.006), (I-749)+(2.011)+(3.007), (I-749)+(2.011)+(3.008), (I-749)+(2.011)+(3.009), (I-749)+(2.011)+(3.010), (I-749)+(2.011)+(3.011), (I-749)+(2.011)+(3.012), (I-749)+(2.011)+(3.013), (I-749)+(2.011)+(3.014), (I-749)+(2.011)+(3.015), (I-749)+(2.011)+(3.016), (I-749)+(2.011)+(3.017), (I-749)+(2.011)+(3.018), (I-749)+(2.011)+(3.019), (I-749)+(2.011)+(3.020), (I-749)+(2.011)+(3.021), (I-749)+(2.011)+(3.022), (I-749)+(2.011)+(3.023), (I-749)+(2.011)+(3.024), (I-749)+(2.011)+(3.025), (I-749)+(2.011)+(3.026), (I-749)+(2.011)+(3.027), (I-749)+(2.011)+(3.028), (I-749)+(2.011)+(3.029), (I-749)+(2.011)+(3.030), (I-749)+(2.011)+(3.031), (I-749)+(2.011)+(5.001), (I-749)+(2.011)+(5.002), (I-749)+(2.011)+(5.003), (I-749)+(2.011)+(5.004), (I-749)+(2.011)+(5.005), (I-749)+(2.011)+(5.006), (I-749)+(2.011)+(5.007), (I-749)+(2.011)+(5.008), (I-749)+(2.011)+(5.009), (I-749)+(2.011)+(5.010), (I-749)+(2.011)+(5.011), (I-749)+(2.011)+(5.012), (I-749)+(2.011)+(5.013), (I-749)+(2.011)+(5.014), (I-749)+(2.011)+(5.015), (I-749)+(2.011)+(5.016), (I-749)+(2.011)+(5.017), (I-749)+(2.011)+(5.018), (I-749)+(2.011)+(5.019), (I-749)+(2.011)+(5.020), (I-749)+(2.011)+(5.021), (I-749)+(2.011)+(5.022), (I-749)+(2.011)+(5.023), (I-749)+(2.011)+(6.001), (I-749)+(2.011)+(6.002), (I-749)+(2.011)+(6.003), (I-749)+(2.011)+(6.004), (I-749)+(2.011)+(7.001), (I-749)+(2.011)+(7.002), (I-749)+(2.011)+(7.003), (I-749)+(2.011)+(7.004), (I-749)+(2.011)+(7.005), (I-749)+(2.011)+(7.006), (I-749)+(2.011)+(9.001), (I-749)+(2.011)+(9.002), (I-749)+(2.011)+(9.003), (I-749)+(2.011)+(9.004), (I-749)+(2.011)+(9.005), (I-749)+(2.011)+(9.006), (I-749)+(2.011)+(9.007), (I-749)+(2.011)+(9.008), (I-749)+(2.011)+(9.009), (I-749)+(2.011)+(14.001), (I-749)+(2.011)+(14.002), (I-749)+(2.011)+(15.008), (I-749)+(2.011)+(15.011), (I-749)+(2.011)+(15.012), (I-749)+(2.011)+(15.016), (I-749)+(2.011)+(15.025), (I-749)+(2.011)+(15.027), (I-749)+(2.011)+(15.047), (I-749)+(2.011)+(15.063), (I-749)+(2.011)+(15.064), (I-749)+(2.011)+(16.001), (I-749)+(2.011)+(16.002), (I-749)+(2.011)+(16.003), (I-749)+(2.011)+(16.004), (I-749)+(2.011)+(16.005), (I-749)+(2.011)+(16.006), (I-749)+(2.011)+(16.007), (I-749)+(2.011)+(16.008), (I-749)+(2.011)+(17.001), (I-749)+(2.011)+(17.002), (I-749)+(2.011)+(17.003), (I-749)+(2.011)+(17.004), (I-749)+(2.011)+(17.005), (I-749)+(2.011)+(17.006), (I-749)+(2.011)+(17.007), (I-749)+(2.011)+(17.008), (I-749)+(2.011)+(17.009), (I-749)+(2.011)+(17.010), (I-749)+(2.011)+(17.011), (I-749)+(2.011)+(17.012), (I-749)+(2.011)+(18.001),

(I-749)+(2.012)+(3.001), (I-749)+(2.012)+(3.002), (I-749)+(2.012)+(3.003), (I-749)+(2.012)+(3.004), (I-749)+(2.012)+(3.005), (I-749)+(2.012)+(3.006), (I-749)+(2.012)+(3.007), (I-749)+(2.012)+(3.008), (I-749)+(2.012)+(3.009), (I-749)+(2.012)+(3.010), (I-749)+(2.012)+(3.011), (I-749)+(2.012)+(3.012), (I-749)+(2.012)+(3.013), (I-749)+(2.012)+(3.014), (I-749)+(2.012)+(3.015), (I-749)+(2.012)+(3.016), (I-749)+(2.012)+(3.017), (I-749)+(2.012)+(3.018), (I-749)+(2.012)+(3.019), (I-749)+(2.012)+(3.020), (I-749)+(2.012)+(3.021), (I-749)+(2.012)+(3.022), (I-749)+(2.012)+(3.023), (I-749)+(2.012)+(3.024), (I-749)+(2.012)+(3.025), (I-749)+(2.012)+(3.026), (I-749)+(2.012)+(3.027), (I-749)+(2.012)+(3.028), (I-749)+(2.012)+(3.029), (I-749)+(2.012)+(3.030), (I-749)+(2.012)+(3.031), (I-749)+(2.012)+(5.001), (I-749)+(2.012)+(5.002), (I-749)+(2.012)+(5.003), (I-749)+(2.012)+(5.004), (I-749)+(2.012)+(5.005), (I-749)+(2.012)+(5.006), (I-749)+(2.012)+(5.007), (I-749)+(2.012)+(5.008), (I-749)+(2.012)+(5.009), (I-749)+(2.012)+(5.010), (I-749)+(2.012)+(5.011), (I-749)+(2.012)+(5.012), (I-749)+(2.012)+(5.013), (I-749)+(2.012)+(5.014), (I-749)+(2.012)+(5.015), (I-749)+(2.012)+(5.016), (I-749)+(2.012)+(5.017), (I-749)+(2.012)+(5.018), (I-749)+(2.012)+(5.019), (I-749)+(2.012)+(5.020), (I-749)+(2.012)+(5.021), (I-749)+(2.012)+(5.022), (I-749)+(2.012)+(5.023), (I-749)+(2.012)+(6.001), (I-749)+(2.012)+(6.002), (I-749)+(2.012)+(6.003), (I-749)+(2.012)+(6.004), (I-749)+(2.012)+(7.001), (I-749)+(2.012)+(7.002), (I-749)+(2.012)+(7.003), (I-749)+(2.012)+(7.004), (I-749)+(2.012)+(7.005), (I-749)+(2.012)+(7.006), (I-749)+(2.012)+(9.001), (I-749)+(2.012)+(9.002), (I-749)+(2.012)+(9.003), (I-749)+(2.012)+(9.004), (I-749)+(2.012)+(9.005), (I-749)+(2.012)+(9.006), (I-749)+(2.012)+(9.007), (I-749)+(2.012)+(9.008), (I-749)+(2.012)+(9.009), (I-749)+(2.012)+(14.001), (I-749)+(2.012)+(14.002), (I-749)+(2.012)+(15.008), (I-749)+(2.012)+(15.011), (I-749)+(2.012)+(15.012), (I-749)+(2.012)+(15.016), (I-749)+(2.012)+(15.025), (I-749)+(2.012)+(15.027), (I-749)+(2.012)+(15.047), (I-749)+(2.012)+(15.063), (I-749)+(2.012)+(15.064), (I-749)+(2.012)+(16.001), (I-749)+(2.012)+(16.002), (I-749)+(2.012)+(16.003), (I-749)+(2.012)+(16.004), (I-749)+(2.012)+(16.005), (I-749)+(2.012)+(16.006), (I-749)+(2.012)+(16.007), (I-749)+(2.012)+(16.008), (I-749)+(2.012)+(17.001), (I-749)+(2.012)+(17.002), (I-749)+(2.012)+(17.003), (I-749)+(2.012)+(17.004), (I-749)+(2.012)+(17.005), (I-749)+(2.012)+(17.006), (I-749)+(2.012)+(17.007), (I-749)+(2.012)+(17.008), (I-749)+(2.012)+(17.009), (I-749)+(2.012)+(17.010), (I-749)+(2.012)+(17.011), (I-749)+(2.012)+(17.012), (I-749)+(2.012)+(18.001),

(I-749)+(2.013)+(3.001), (I-749)+(2.013)+(3.002), (I-749)+(2.013)+(3.003), (I-749)+(2.013)+(3.004), (I-749)+(2.013)+(3.005), (I-749)+(2.013)+(3.006), (I-749)+(2.013)+(3.007), (I-749)+(2.013)+(3.008), (I-749)+(2.013)+(3.009), (I-749)+(2.013)+(3.010), (I-749)+(2.013)+(3.011), (I-749)+(2.013)+(3.012), (I-749)+(2.013)+(3.013), (I-749)+(2.013)+(3.014), (I-749)+(2.013)+(3.015), (I-749)+(2.013)+(3.016), (I-749)+(2.013)+(3.017), (I-749)+(2.013)+(3.018), (I-749)+(2.013)+(3.019), (I-749)+(2.013)+(3.020), (I-749)+(2.013)+(3.021), (I-749)+(2.013)+(3.022), (I-749)+(2.013)+(3.023), (I-749)+(2.013)+(3.024), (I-749)+(2.013)+(3.025), (I-749)+(2.013)+(3.026), (I-749)+(2.013)+(3.027), (I-749)+(2.013)+(3.028), (I-749)+(2.013)+(3.029), (I-749)+(2.013)+(3.030), (I-749)+(2.013)+(3.031), (I-749)+(2.013)+(5.001), (I-749)+(2.013)+(5.002), (I-749)+(2.013)+(5.003), (I-749)+(2.013)+(5.004), (I-749)+(2.013)+(5.005), (I-749)+(2.013)+(5.006), (I-749)+(2.013)+(5.007), (I-749)+(2.013)+(5.008), (I-749)+(2.013)+(5.009), (I-749)+(2.013)+(5.010), (I-749)+(2.013)+(5.011), (I-749)+(2.013)+(5.012), (I-749)+(2.013)+(5.013), (I-749)+(2.013)+(5.014), (I-749)+(2.013)+(5.015), (I-749)+(2.013)+(5.016), (I-749)+(2.013)+(5.017), (I-749)+(2.013)+(5.018), (I-749)+(2.013)+(5.019), (I-749)+(2.013)+(5.020), (I-749)+(2.013)+(5.021), (I-749)+(2.013)+(5.022), (I-749)+(2.013)+(5.023), (I-749)+(2.013)+(6.001), (I-749)+(2.013)+(6.002), (I-749)+(2.013)+(6.003), (I-749)+(2.013)+(6.004), (I-749)+(2.013)+(7.001), (I-749)+(2.013)+(7.002), (I-749)+(2.013)+(7.003), (I-749)+(2.013)+(7.004), (I-749)+(2.013)+(7.005), (I-749)+(2.013)+(7.006), (I-749)+(2.013)+(9.001), (I-749)+(2.013)+(9.002), (I-749)+(2.013)+(9.003), (I-749)+(2.013)+(9.004), (I-749)+(2.013)+(9.005), (I-749)+(2.013)+(9.006), (I-749)+(2.013)+(9.007), (I-749)+(2.013)+(9.008), (I-749)+(2.013)+(9.009), (I-749)+(2.013)+(14.001), (I-749)+(2.013)+(14.002), (I-749)+(2.013)+(15.008), (I-749)+(2.013)+(15.011), (I-749)+(2.013)+(15.012), (I-749)+(2.013)+(15.016), (I-749)+(2.013)+(15.025), (I-749)+(2.013)+(15.027), (I-749)+(2.013)+(15.047), (I-749)+(2.013)+(15.063), (I-749)+(2.013)+(15.064), (I-749)+(2.013)+(16.001), (I-749)+(2.013)+(16.002), (I-749)+(2.013)+(16.003), (I-749)+(2.013)+(16.004), (I-749)+(2.013)+(16.005), (I-749)+(2.013)+(16.006), (I-749)+(2.013)+(16.007), (I-749)+(2.013)+(16.008), (I-749)+(2.013)+(17.001), (I-749)+(2.013)+(17.002), (I-749)+(2.013)+(17.003), (I-749)+(2.013)+(17.004), (I-749)+(2.013)+(17.005), (I-749)+(2.013)+(17.006), (I-749)+(2.013)+(17.007), (I-749)+(2.013)+(17.008), (I-749)+(2.013)+(17.009), (I-749)+(2.013)+(17.010), (I-749)+(2.013)+(17.011), (I-749)+(2.013)+(17.012), (I-749)+(2.013)+(18.001),

(I-749)+(2.014)+(3.001), (I-749)+(2.014)+(3.002), (I-749)+(2.014)+(3.003), (I-749)+(2.014)+(3.004), (I-749)+(2.014)+(3.005), (I-749)+(2.014)+(3.006), (I-749)+(2.014)+(3.007), (I-749)+(2.014)+(3.008), (I-749)+(2.014)+(3.009), (I-749)+(2.014)+(3.010), (I-749)+(2.014)+(3.011), (I-749)+(2.014)+(3.012), (I-749)+(2.014)+(3.013), (I-749)+(2.014)+(3.014), (I-749)+(2.014)+(3.015), (I-749)+(2.014)+(3.016), (I-749)+(2.014)+(3.017), (I-749)+(2.014)+(3.018), (I-749)+(2.014)+(3.019), (I-749)+(2.014)+(3.020), (I-749)+(2.014)+(3.021), (I-749)+(2.014)+(3.022), (I-749)+(2.014)+(3.023), (I-749)+(2.014)+(3.024), (I-749)+(2.014)+(3.025), (I-749)+(2.014)+(3.026), (I-749)+(2.014)+(3.027), (I-749)+(2.014)+(3.028), (I-749)+(2.014)+(3.029), (I-749)+(2.014)+(3.030), (I-749)+(2.014)+(3.031), (I-749)+(2.014)+(5.001), (I-749)+(2.014)+(5.002), (I-749)+(2.014)+(5.003), (I-749)+(2.014)+(5.004), (I-749)+(2.014)+(5.005), (I-749)+(2.014)+(5.006), (I-749)+(2.014)+(5.007), (I-749)+(2.014)+(5.008), (I-749)+(2.014)+(5.009), (I-749)+(2.014)+(5.010), (I-749)+(2.014)+(5.011), (I-749)+(2.014)+(5.012), (I-749)+(2.014)+(5.013), (I-749)+(2.014)+(5.014), (I-749)+(2.014)+(5.015), (I-749)+(2.014)+(5.016), (I-749)+(2.014)+(5.017), (I-749)+(2.014)+(5.018), (I-749)+(2.014)+(5.019), (I-749)+(2.014)+(5.020), (I-749)+(2.014)+(5.021), (I-749)+(2.014)+(5.022), (I-749)+(2.014)+(5.023), (I-749)+(2.014)+(6.001), (I-749)+(2.014)+(6.002), (I-749)+(2.014)+(6.003), (I-749)+(2.014)+(6.004), (I-749)+(2.014)+(7.001), (I-749)+(2.014)+(7.002), (I-749)+(2.014)+(7.003), (I-749)+(2.014)+(7.004), (I-749)+(2.014)+(7.005), (I-749)+(2.014)+(7.006), (I-749)+(2.014)+(9.001), (I-749)+(2.014)+(9.002), (I-749)+(2.014)+(9.003), (I-749)+(2.014)+(9.004), (I-749)+(2.014)+(9.005), (I-749)+(2.014)+(9.006), (I-749)+(2.014)+(9.007), (I-749)+(2.014)+(9.008), (I-749)+(2.014)+(9.009), (I-749)+(2.014)+(14.001), (I-749)+(2.014)+(14.002), (I-749)+(2.014)+(15.008), (I-749)+(2.014)+(15.011), (I-749)+(2.014)+(15.012), (I-749)+(2.014)+(15.016), (I-749)+(2.014)+(15.025), (I-749)+(2.014)+(15.027), (I-749)+(2.014)+(15.047), (I-749)+(2.014)+(15.063), (I-749)+(2.014)+(15.064), (I-749)+(2.014)+(16.001), (I-749)+(2.014)+(16.002), (I-749)+(2.014)+(16.003), (I-749)+(2.014)+(16.004), (I-749)+(2.014)+(16.005), (I-749)+(2.014)+(16.006), (I-749)+(2.014)+(16.007), (I-749)+(2.014)+(16.008), (I-749)+(2.014)+(17.001), (I-749)+(2.014)+(17.002), (I-749)+(2.014)+(17.003), (I-749)+(2.014)+(17.004), (I-749)+(2.014)+(17.005), (I-749)+(2.014)+(17.006), (I-749)+(2.014)+(17.007), (I-749)+(2.014)+(17.008), (I-749)+(2.014)+(17.009), (I-749)+(2.014)+(17.010), (I-749)+(2.014)+(17.011), (I-749)+(2.014)+(17.012), (I-749)+(2.014)+(18.001),

(I-749)+(2.015)+(3.001), (I-749)+(2.015)+(3.002), (I-749)+(2.015)+(3.003), (I-749)+(2.015)+(3.004), (I-749)+(2.015)+(3.005), (I-749)+(2.015)+(3.006), (I-749)+(2.015)+(3.007), (I-749)+(2.015)+(3.008), (I-749)+(2.015)+(3.009), (I-749)+(2.015)+(3.010), (I-749)+(2.015)+(3.011), (I-749)+(2.015)+(3.012), (I-749)+(2.015)+(3.013), (I-749)+(2.015)+(3.014), (I-749)+(2.015)+(3.015), (I-749)+(2.015)+(3.016), (I-749)+(2.015)+(3.017), (I-749)+(2.015)+(3.018), (I-749)+(2.015)+(3.019), (I-749)+(2.015)+(3.020), (I-749)+(2.015)+(3.021), (I-749)+(2.015)+(3.022), (I-749)+(2.015)+(3.023), (I-749)+(2.015)+(3.024), (I-749)+(2.015)+(3.025), (I-749)+(2.015)+(3.026), (I-749)+(2.015)+(3.027), (I-749)+(2.015)+(3.028), (I-749)+(2.015)+(3.029), (I-749)+(2.015)+(3.030), (I-749)+(2.015)+(3.031), (I-749)+(2.015)+(5.001), (I-749)+(2.015)+(5.002), (I-749)+(2.015)+(5.003), (I-749)+(2.015)+(5.004), (I-749)+(2.015)+(5.005), (I-749)+(2.015)+(5.006), (I-749)+(2.015)+(5.007), (I-749)+(2.015)+(5.008), (I-749)+(2.015)+(5.009), (I-749)+(2.015)+(5.010), (I-749)+(2.015)+(5.011), (I-749)+(2.015)+(5.012), (I-749)+(2.015)+(5.013), (I-749)+(2.015)+(5.014), (I-749)+(2.015)+(5.015), (I-749)+(2.015)+(5.016), (I-749)+(2.015)+(5.017), (I-749)+(2.015)+(5.018), (I-749)+(2.015)+(5.019), (I-749)+(2.015)+(5.020), (I-749)+(2.015)+(5.021), (I-749)+(2.015)+(5.022), (I-749)+(2.015)+(5.023), (I-749)+(2.015)+(6.001), (I-749)+(2.015)+(6.002), (I-749)+(2.015)+(6.003), (I-749)+(2.015)+(6.004), (I-749)+(2.015)+(7.001), (I-749)+(2.015)+(7.002), (I-749)+(2.015)+(7.003), (I-749)+(2.015)+(7.004), (I-749)+(2.015)+(7.005), (I-749)+(2.015)+(7.006), (I-749)+(2.015)+(9.001), (I-749)+(2.015)+(9.002), (I-749)+(2.015)+(9.003), (I-749)+(2.015)+(9.004), (I-749)+(2.015)+(9.005), (I-749)+(2.015)+(9.006), (I-749)+(2.015)+(9.007), (I-749)+(2.015)+(9.008), (I-749)+(2.015)+(9.009), (I-749)+(2.015)+(14.001), (I-749)+(2.015)+(14.002), (I-749)+(2.015)+(15.008), (I-749)+(2.015)+(15.011), (I-749)+(2.015)+(15.012), (I-749)+(2.015)+(15.016), (I-749)+(2.015)+(15.025), (I-749)+(2.015)+(15.027), (I-749)+(2.015)+(15.047), (I-749)+(2.015)+(15.063), (I-749)+(2.015)+(15.064), (I-749)+(2.015)+(16.001), (I-749)+(2.015)+(16.002), (I-749)+(2.015)+(16.003), (I-749)+(2.015)+(16.004), (I-749)+(2.015)+(16.005), (I-749)+(2.015)+(16.006), (I-749)+(2.015)+(16.007), (I-749)+(2.015)+(16.008), (I-749)+(2.015)+(17.001), (I-749)+(2.015)+(17.002), (I-749)+(2.015)+(17.003), (I-749)+(2.015)+(17.004), (I-749)+(2.015)+(17.005), (I-749)+(2.015)+(17.006), (I-749)+(2.015)+(17.007), (I-749)+(2.015)+(17.008), (I-749)+(2.015)+(17.009), (I-749)+(2.015)+(17.010), (I-749)+(2.015)+(17.011), (I-749)+(2.015)+(17.012), (I-749)+(2.015)+(18.001),

(I-749)+(2.016)+(3.001), (I-749)+(2.016)+(3.002), (I-749)+(2.016)+(3.003), (I-749)+(2.016)+(3.004), (I-749)+(2.016)+(3.005), (I-749)+(2.016)+(3.006), (I-749)+(2.016)+(3.007), (I-749)+(2.016)+(3.008), (I-749)+(2.016)+(3.009), (I-749)+(2.016)+(3.010), (I-749)+(2.016)+(3.011), (I-749)+(2.016)+(3.012), (I-749)+(2.016)+(3.013), (I-749)+(2.016)+(3.014), (I-749)+(2.016)+(3.015), (I-749)+(2.016)+(3.016), (I-749)+(2.016)+(3.017), (I-749)+(2.016)+(3.018), (I-749)+(2.016)+(3.019), (I-749)+(2.016)+(3.020), (I-749)+(2.016)+(3.021), (I-749)+(2.016)+(3.022), (I-749)+(2.016)+(3.023), (I-749)+(2.016)+(3.024), (I-749)+(2.016)+(3.025), (I-749)+(2.016)+(3.026), (I-749)+(2.016)+(3.027), (I-749)+(2.016)+(3.028), (I-749)+(2.016)+(3.029), (I-749)+(2.016)+(3.030), (I-749)+(2.016)+(3.031), (I-749)+(2.016)+(5.001), (I-749)+(2.016)+(5.002), (I-749)+(2.016)+(5.003), (I-749)+(2.016)+(5.004), (I-749)+(2.016)+(5.005), (I-749)+(2.016)+(5.006), (I-749)+(2.016)+(5.007), (I-749)+(2.016)+(5.008), (I-749)+(2.016)+(5.009), (I-749)+(2.016)+(5.010), (I-749)+(2.016)+(5.011), (I-749)+(2.016)+(5.012), (I-749)+(2.016)+(5.013), (I-749)+(2.016)+(5.014), (I-749)+(2.016)+(5.015), (I-749)+(2.016)+(5.016), (I-749)+(2.016)+(5.017), (I-749)+(2.016)+(5.018), (I-749)+(2.016)+(5.019), (I-749)+(2.016)+(5.020), (I-749)+(2.016)+(5.021), (I-749)+(2.016)+(5.022), (I-749)+(2.016)+(5.023), (I-749)+(2.016)+(6.001), (I-749)+(2.016)+(6.002), (I-749)+(2.016)+(6.003), (I-749)+(2.016)+(6.004), (I-749)+(2.016)+(7.001), (I-749)+(2.016)+(7.002), (I-749)+(2.016)+(7.003), (I-749)+(2.016)+(7.004), (I-749)+(2.016)+(7.005), (I-749)+(2.016)+(7.006), (I-749)+(2.016)+(9.001), (I-749)+(2.016)+(9.002), (I-749)+(2.016)+(9.003), (I-749)+(2.016)+(9.004), (I-749)+(2.016)+(9.005), (I-749)+(2.016)+(9.006), (I-749)+(2.016)+(9.007), (I-749)+(2.016)+(9.008), (I-749)+(2.016)+(9.009), (I-749)+(2.016)+(14.001), (I-749)+(2.016)+(14.002), (I-749)+(2.016)+(15.008), (I-749)+(2.016)+(15.011), (I-749)+(2.016)+(15.012), (I-749)+(2.016)+(15.016), (I-749)+(2.016)+(15.025), (I-749)+(2.016)+(15.027), (I-749)+(2.016)+(15.047), (I-749)+(2.016)+(15.063), (I-749)+(2.016)+(15.064), (I-749)+(2.016)+(16.001), (I-749)+(2.016)+(16.002), (I-749)+(2.016)+(16.003), (I-749)+(2.016)+(16.004), (I-749)+(2.016)+(16.005), (I-749)+(2.016)+(16.006), (I-749)+(2.016)+(16.007), (I-749)+(2.016)+(16.008), (I-749)+(2.016)+(17.001), (I-749)+(2.016)+(17.002), (I-749)+(2.016)+(17.003), (I-749)+(2.016)+(17.004), (I-749)+(2.016)+(17.005), (I-749)+(2.016)+(17.006), (I-749)+(2.016)+(17.007), (I-749)+(2.016)+(17.008), (I-749)+(2.016)+(17.009), (I-749)+(2.016)+(17.010), (I-749)+(2.016)+(17.011), (I-749)+(2.016)+(17.012), (I-749)+(2.016)+(18.001),

(I-749)+(2.017)+(3.001), (I-749)+(2.017)+(3.002), (I-749)+(2.017)+(3.003), (I-749)+(2.017)+(3.004), (I-749)+(2.017)+(3.005), (I-749)+(2.017)+(3.006), (I-749)+(2.017)+(3.007), (I-749)+(2.017)+(3.008), (I-749)+(2.017)+(3.009), (I-749)+(2.017)+(3.010), (I-749)+(2.017)+(3.011), (I-749)+(2.017)+(3.012), (I-749)+(2.017)+(3.013), (I-749)+(2.017)+(3.014), (I-749)+(2.017)+(3.015), (I-749)+(2.017)+(3.016), (I-749)+(2.017)+(3.017), (I-749)+(2.017)+(3.018), (I-749)+(2.017)+(3.019), (I-749)+(2.017)+(3.020), (I-749)+(2.017)+(3.021), (I-749)+(2.017)+(3.022), (I-749)+(2.017)+(3.023), (I-749)+(2.017)+(3.024), (I-749)+(2.017)+(3.025), (I-749)+(2.017)+(3.026), (I-749)+(2.017)+(3.027), (I-749)+(2.017)+(3.028), (I-749)+(2.017)+(3.029), (I-749)+(2.017)+(3.030), (I-749)+(2.017)+(3.031), (I-749)+(2.017)+(5.001), (I-749)+(2.017)+(5.002), (I-749)+(2.017)+(5.003), (I-749)+(2.017)+(5.004), (I-749)+(2.017)+(5.005), (I-749)+(2.017)+(5.006), (I-749)+(2.017)+(5.007), (I-749)+(2.017)+(5.008), (I-749)+(2.017)+(5.009), (I-749)+(2.017)+(5.010), (I-749)+(2.017)+(5.011), (I-749)+(2.017)+(5.012), (I-749)+(2.017)+(5.013), (I-749)+(2.017)+(5.014), (I-749)+(2.017)+(5.015), (I-749)+(2.017)+(5.016), (I-749)+(2.017)+(5.017), (I-749)+(2.017)+(5.018), (I-749)+(2.017)+(5.019), (I-749)+(2.017)+(5.020), (I-749)+(2.017)+(5.021), (I-749)+(2.017)+(5.022), (I-749)+(2.017)+(5.023), (I-749)+(2.017)+(6.001), (I-749)+(2.017)+(6.002), (I-749)+(2.017)+(6.003), (I-749)+(2.017)+(6.004), (I-749)+(2.017)+(7.001), (I-749)+(2.017)+(7.002), (I-749)+(2.017)+(7.003), (I-749)+(2.017)+(7.004), (I-749)+(2.017)+(7.005), (I-749)+(2.017)+(7.006), (I-749)+(2.017)+(9.001), (I-749)+(2.017)+(9.002), (I-749)+(2.017)+(9.003), (I-749)+(2.017)+(9.004), (I-749)+(2.017)+(9.005), (I-749)+(2.017)+(9.006), (I-749)+(2.017)+(9.007), (I-749)+(2.017)+(9.008), (I-749)+(2.017)+(9.009), (I-749)+(2.017)+(14.001), (I-749)+(2.017)+(14.002), (I-749)+(2.017)+(15.008), (I-749)+(2.017)+(15.011), (I-749)+(2.017)+(15.012), (I-749)+(2.017)+(15.016), (I-749)+(2.017)+(15.025), (I-749)+(2.017)+(15.027), (I-749)+(2.017)+(15.047), (I-749)+(2.017)+(15.063), (I-749)+(2.017)+(15.064), (I-749)+(2.017)+(16.001), (I-749)+(2.017)+(16.002), (I-749)+(2.017)+(16.003), (I-749)+(2.017)+(16.004), (I-749)+(2.017)+(16.005), (I-749)+(2.017)+(16.006), (I-749)+(2.017)+(16.007), (I-749)+(2.017)+(16.008), (I-749)+(2.017)+(17.001), (I-749)+(2.017)+(17.002), (I-749)+(2.017)+(17.003), (I-749)+(2.017)+(17.004), (I-749)+(2.017)+(17.005), (I-749)+(2.017)+(17.006), (I-749)+(2.017)+(17.007), (I-749)+(2.017)+(17.008), (I-749)+(2.017)+(17.009), (I-749)+(2.017)+(17.010), (I-749)+(2.017)+(17.011), (I-749)+(2.017)+(17.012), (I-749)+(2.017)+(18.001),

(I-749)+(2.018)+(3.001), (I-749)+(2.018)+(3.002), (I-749)+(2.018)+(3.003), (I-749)+(2.018)+(3.004), (I-749)+(2.018)+(3.005), (I-749)+(2.018)+(3.006), (I-749)+(2.018)+(3.007), (I-749)+(2.018)+(3.008), (I-749)+(2.018)+(3.009), (I-749)+(2.018)+(3.010), (I-749)+(2.018)+(3.011), (I-749)+(2.018)+(3.012), (I-749)+(2.018)+(3.013), (I-749)+(2.018)+(3.014), (I-749)+(2.018)+(3.015), (I-749)+(2.018)+(3.016), (I-749)+(2.018)+(3.017), (I-749)+(2.018)+(3.018), (I-749)+(2.018)+(3.019), (I-749)+(2.018)+(3.020), (I-749)+(2.018)+(3.021), (I-749)+(2.018)+(3.022), (I-749)+(2.018)+(3.023), (I-749)+(2.018)+(3.024), (I-749)+(2.018)+(3.025), (I-749)+(2.018)+(3.026), (I-749)+(2.018)+(3.027), (I-749)+(2.018)+(3.028), (I-749)+(2.018)+(3.029), (I-749)+(2.018)+(3.030), (I-749)+(2.018)+(3.031), (I-749)+(2.018)+(5.001), (I-749)+(2.018)+(5.002), (I-749)+(2.018)+(5.003), (I-749)+(2.018)+(5.004), (I-749)+(2.018)+(5.005), (I-749)+(2.018)+(5.006), (I-749)+(2.018)+(5.007), (I-749)+(2.018)+(5.008), (I-749)+(2.018)+(5.009), (I-749)+(2.018)+(5.010), (I-749)+(2.018)+(5.011), (I-749)+(2.018)+(5.012), (I-749)+(2.018)+(5.013), (I-749)+(2.018)+(5.014), (I-749)+(2.018)+(5.015), (I-749)+(2.018)+(5.016), (I-749)+(2.018)+(5.017), (I-749)+(2.018)+(5.018), (I-749)+(2.018)+(5.019), (I-749)+(2.018)+(5.020), (I-749)+(2.018)+(5.021), (I-749)+(2.018)+(5.022), (I-749)+(2.018)+(5.023), (I-749)+(2.018)+(6.001), (I-749)+(2.018)+(6.002), (I-749)+(2.018)+(6.003), (I-749)+(2.018)+(6.004), (I-749)+(2.018)+(7.001), (I-749)+(2.018)+(7.002), (I-749)+(2.018)+(7.003), (I-749)+(2.018)+(7.004), (I-749)+(2.018)+(7.005), (I-749)+(2.018)+(7.006), (I-749)+(2.018)+(9.001), (I-749)+(2.018)+(9.002), (I-749)+(2.018)+(9.003), (I-749)+(2.018)+(9.004), (I-749)+(2.018)+(9.005), (I-749)+(2.018)+(9.006), (I-749)+(2.018)+(9.007), (I-749)+(2.018)+(9.008), (I-749)+(2.018)+(9.009), (I-749)+(2.018)+(14.001), (I-749)+(2.018)+(14.002), (I-749)+(2.018)+(15.008), (I-749)+(2.018)+(15.011), (I-749)+(2.018)+(15.012), (I-749)+(2.018)+(15.016), (I-749)+(2.018)+(15.025), (I-749)+(2.018)+(15.027), (I-749)+(2.018)+(15.047), (I-749)+(2.018)+(15.063), (I-749)+(2.018)+(15.064), (I-749)+(2.018)+(16.001), (I-749)+(2.018)+(16.002), (I-749)+(2.018)+(16.003), (I-749)+(2.018)+(16.004), (I-749)+(2.018)+(16.005), (I-749)+(2.018)+(16.006), (I-749)+(2.018)+(16.007), (I-749)+(2.018)+(16.008), (I-749)+(2.018)+(17.001), (I-749)+(2.018)+(17.002), (I-749)+(2.018)+(17.003), (I-749)+(2.018)+(17.004), (I-749)+(2.018)+(17.005), (I-749)+(2.018)+(17.006), (I-749)+(2.018)+(17.007), (I-749)+(2.018)+(17.008), (I-749)+(2.018)+(17.009), (I-749)+(2.018)+(17.010), (I-749)+(2.018)+(17.011), (I-749)+(2.018)+(17.012), (I-749)+(2.018)+(18.001),

(I-749)+(2.019)+(3.001), (I-749)+(2.019)+(3.002), (I-749)+(2.019)+(3.003), (I-749)+(2.019)+(3.004), (I-749)+(2.019)+(3.005), (I-749)+(2.019)+(3.006), (I-749)+(2.019)+(3.007), (I-749)+(2.019)+(3.008), (I-749)+(2.019)+(3.009), (I-749)+(2.019)+(3.010), (I-749)+(2.019)+(3.011), (I-749)+(2.019)+(3.012), (I-749)+(2.019)+(3.013), (I-749)+(2.019)+(3.014), (I-749)+(2.019)+(3.015), (I-749)+(2.019)+(3.016), (I-749)+(2.019)+(3.017), (I-749)+(2.019)+(3.018), (I-749)+(2.019)+(3.019), (I-749)+(2.019)+(3.020), (I-749)+(2.019)+(3.021), (I-749)+(2.019)+(3.022), (I-749)+(2.019)+(3.023), (I-749)+(2.019)+(3.024), (I-749)+(2.019)+(3.025), (I-749)+(2.019)+(3.026), (I-749)+(2.019)+(3.027), (I-749)+(2.019)+(3.028), (I-749)+(2.019)+(3.029), (I-749)+(2.019)+(3.030), (I-749)+(2.019)+(3.031), (I-749)+(2.019)+(5.001), (I-749)+(2.019)+(5.002), (I-749)+(2.019)+(5.003), (I-749)+(2.019)+(5.004), (I-749)+(2.019)+(5.005), (I-749)+(2.019)+(5.006), (I-749)+(2.019)+(5.007), (I-749)+(2.019)+(5.008), (I-749)+(2.019)+(5.009), (I-749)+(2.019)+(5.010), (I-749)+(2.019)+(5.011), (I-749)+(2.019)+(5.012), (I-749)+(2.019)+(5.013), (I-749)+(2.019)+(5.014), (I-749)+(2.019)+(5.015), (I-749)+(2.019)+(5.016), (I-749)+(2.019)+(5.017), (I-749)+(2.019)+(5.018), (I-749)+(2.019)+(5.019), (I-749)+(2.019)+(5.020), (I-749)+(2.019)+(5.021), (I-749)+(2.019)+(5.022), (I-749)+(2.019)+(5.023), (I-749)+(2.019)+(6.001), (I-749)+(2.019)+(6.002), (I-749)+(2.019)+(6.003), (I-749)+(2.019)+(6.004), (I-749)+(2.019)+(7.001), (I-749)+(2.019)+(7.002), (I-749)+(2.019)+(7.003), (I-749)+(2.019)+(7.004), (I-749)+(2.019)+(7.005), (I-749)+(2.019)+(7.006), (I-749)+(2.019)+(9.001), (I-749)+(2.019)+(9.002), (I-749)+(2.019)+(9.003), (I-749)+(2.019)+(9.004), (I-749)+(2.019)+(9.005), (I-749)+(2.019)+(9.006), (I-749)+(2.019)+(9.007), (I-749)+(2.019)+(9.008), (I-749)+(2.019)+(9.009), (I-749)+(2.019)+(14.001), (I-749)+(2.019)+(14.002), (I-749)+(2.019)+(15.008), (I-749)+(2.019)+(15.011), (I-749)+(2.019)+(15.012), (I-749)+(2.019)+(15.016), (I-749)+(2.019)+(15.025), (I-749)+(2.019)+(15.027), (I-749)+(2.019)+(15.047), (I-749)+(2.019)+(15.063), (I-749)+(2.019)+(15.064), (I-749)+(2.019)+(16.001), (I-749)+(2.019)+(16.002), (I-749)+(2.019)+(16.003), (I-749)+(2.019)+(16.004), (I-749)+(2.019)+(16.005), (I-749)+(2.019)+(16.006), (I-749)+(2.019)+(16.007), (I-749)+(2.019)+(16.008), (I-749)+(2.019)+(17.001), (I-749)+(2.019)+(17.002), (I-749)+(2.019)+(17.003), (I-749)+(2.019)+(17.004), (I-749)+(2.019)+(17.005), (I-749)+(2.019)+(17.006), (I-749)+(2.019)+(17.007), (I-749)+(2.019)+(17.008), (I-749)+(2.019)+(17.009), (I-749)+(2.019)+(17.010), (I-749)+(2.019)+(17.011), (I-749)+(2.019)+(17.012), (I-749)+(2.019)+(18.001),

(I-749)+(2.020)+(3.001), (I-749)+(2.020)+(3.002), (I-749)+(2.020)+(3.003), (I-749)+(2.020)+(3.004), (I-749)+(2.020)+(3.005), (I-749)+(2.020)+(3.006), (I-749)+(2.020)+(3.007), (I-749)+(2.020)+(3.008), (I-749)+(2.020)+(3.009), (I-749)+(2.020)+(3.010), (I-749)+(2.020)+(3.011), (I-749)+(2.020)+(3.012), (I-749)+(2.020)+(3.013), (I-749)+(2.020)+(3.014), (I-749)+(2.020)+(3.015), (I-749)+(2.020)+(3.016), (I-749)+(2.020)+(3.017), (I-749)+(2.020)+(3.018), (I-749)+(2.020)+(3.019), (I-749)+(2.020)+(3.020), (I-749)+(2.020)+(3.021), (I-749)+(2.020)+(3.022), (I-749)+(2.020)+(3.023), (I-749)+(2.020)+(3.024), (I-749)+(2.020)+(3.025), (I-749)+(2.020)+(3.026), (I-749)+(2.020)+(3.027), (I-749)+(2.020)+(3.028), (I-749)+(2.020)+(3.029), (I-749)+(2.020)+(3.030), (I-749)+(2.020)+(3.031), (I-749)+(2.020)+(5.001), (I-749)+(2.020)+(5.002), (I-749)+(2.020)+(5.003), (I-749)+(2.020)+(5.004), (I-749)+(2.020)+(5.005), (I-749)+(2.020)+(5.006), (I-749)+(2.020)+(5.007), (I-749)+(2.020)+(5.008), (I-749)+(2.020)+(5.009), (I-749)+(2.020)+(5.010), (I-749)+(2.020)+(5.011), (I-749)+(2.020)+(5.012), (I-749)+(2.020)+(5.013), (I-749)+(2.020)+(5.014), (I-749)+(2.020)+(5.015), (I-749)+(2.020)+(5.016), (I-749)+(2.020)+(5.017), (I-749)+(2.020)+(5.018), (I-749)+(2.020)+(5.019), (I-749)+(2.020)+(5.020), (I-749)+(2.020)+(5.021), (I-749)+(2.020)+(5.022), (I-749)+(2.020)+(5.023), (I-749)+(2.020)+(6.001), (I-749)+(2.020)+(6.002), (I-749)+(2.020)+(6.003), (I-749)+(2.020)+(6.004), (I-749)+(2.020)+(7.001), (I-749)+(2.020)+(7.002), (I-749)+(2.020)+(7.003), (I-749)+(2.020)+(7.004), (I-749)+(2.020)+(7.005), (I-749)+(2.020)+(7.006), (I-749)+(2.020)+(9.001), (I-749)+(2.020)+(9.002), (I-749)+(2.020)+(9.003), (I-749)+(2.020)+(9.004), (I-749)+(2.020)+(9.005), (I-749)+(2.020)+(9.006), (I-749)+(2.020)+(9.007), (I-749)+(2.020)+(9.008), (I-749)+(2.020)+(9.009), (I-749)+(2.020)+(14.001), (I-749)+(2.020)+(14.002), (I-749)+(2.020)+(15.008), (I-749)+(2.020)+(15.011), (I-749)+(2.020)+(15.012), (I-749)+(2.020)+(15.016), (I-749)+(2.020)+(15.025), (I-749)+(2.020)+(15.027), (I-749)+(2.020)+(15.047), (I-749)+(2.020)+(15.063), (I-749)+(2.020)+(15.064), (I-749)+(2.020)+(16.001), (I-749)+(2.020)+(16.002), (I-749)+(2.020)+(16.003), (I-749)+(2.020)+(16.004), (I-749)+(2.020)+(16.005), (I-749)+(2.020)+(16.006), (I-749)+(2.020)+(16.007), (I-749)+(2.020)+(16.008), (I-749)+(2.020)+(17.001), (I-749)+(2.020)+(17.002), (I-749)+(2.020)+(17.003), (I-749)+(2.020)+(17.004), (I-749)+(2.020)+(17.005), (I-749)+(2.020)+(17.006), (I-749)+(2.020)+(17.007), (I-749)+(2.020)+(17.008), (I-749)+(2.020)+(17.009), (I-749)+(2.020)+(17.010), (I-749)+(2.020)+(17.011), (I-749)+(2.020)+(17.012), (I-749)+(2.020)+(18.001),

(I-749)+(2.021)+(3.001), (I-749)+(2.021)+(3.002), (I-749)+(2.021)+(3.003), (I-749)+(2.021)+(3.004), (I-749)+(2.021)+(3.005), (I-749)+(2.021)+(3.006), (I-749)+(2.021)+(3.007), (I-749)+(2.021)+(3.008), (I-749)+(2.021)+(3.009), (I-749)+(2.021)+(3.010), (I-749)+(2.021)+(3.011), (I-749)+(2.021)+(3.012), (I-749)+(2.021)+(3.013), (I-749)+(2.021)+(3.014), (I-749)+(2.021)+(3.015), (I-749)+(2.021)+(3.016), (I-749)+(2.021)+(3.017), (I-749)+(2.021)+(3.018), (I-749)+(2.021)+(3.019), (I-749)+(2.021)+(3.020), (I-749)+(2.021)+(3.021), (I-749)+(2.021)+(3.022), (I-749)+(2.021)+(3.023), (I-749)+(2.021)+(3.024), (I-749)+(2.021)+(3.025), (I-749)+(2.021)+(3.026), (I-749)+(2.021)+(3.027), (I-749)+(2.021)+(3.028), (I-749)+(2.021)+(3.029), (I-749)+(2.021)+(3.030), (I-749)+(2.021)+(3.031), (I-749)+(2.021)+(5.001), (I-749)+(2.021)+(5.002), (I-749)+(2.021)+(5.003), (I-749)+(2.021)+(5.004), (I-749)+(2.021)+(5.005), (I-749)+(2.021)+(5.006), (I-749)+(2.021)+(5.007), (I-749)+(2.021)+(5.008), (I-749)+(2.021)+(5.009), (I-749)+(2.021)+(5.010), (I-749)+(2.021)+(5.011), (I-749)+(2.021)+(5.012), (I-749)+(2.021)+(5.013), (I-749)+(2.021)+(5.014), (I-749)+(2.021)+(5.015), (I-749)+(2.021)+(5.016), (I-749)+(2.021)+(5.017), (I-749)+(2.021)+(5.018), (I-749)+(2.021)+(5.019), (I-749)+(2.021)+(5.020), (I-749)+(2.021)+(5.021), (I-749)+(2.021)+(5.022), (I-749)+(2.021)+(5.023), (I-749)+(2.021)+(6.001), (I-749)+(2.021)+(6.002), (I-749)+(2.021)+(6.003), (I-749)+(2.021)+(6.004), (I-749)+(2.021)+(7.001), (I-749)+(2.021)+(7.002), (I-749)+(2.021)+(7.003), (I-749)+(2.021)+(7.004), (I-749)+(2.021)+(7.005), (I-749)+(2.021)+(7.006), (I-749)+(2.021)+(9.001), (I-749)+(2.021)+(9.002), (I-749)+(2.021)+(9.003), (I-749)+(2.021)+(9.004), (I-749)+(2.021)+(9.005), (I-749)+(2.021)+(9.006), (I-749)+(2.021)+(9.007), (I-749)+(2.021)+(9.008), (I-749)+(2.021)+(9.009), (I-749)+(2.021)+(14.001), (I-749)+(2.021)+(14.002), (I-749)+(2.021)+(15.008), (I-749)+(2.021)+(15.011), (I-749)+(2.021)+(15.012), (I-749)+(2.021)+(15.016), (I-749)+(2.021)+(15.025), (I-749)+(2.021)+(15.027), (I-749)+(2.021)+(15.047), (I-749)+(2.021)+(15.063), (I-749)+(2.021)+(15.064), (I-749)+(2.021)+(16.001), (I-749)+(2.021)+(16.002), (I-749)+(2.021)+(16.003), (I-749)+(2.021)+(16.004), (I-749)+(2.021)+(16.005), (I-749)+(2.021)+(16.006), (I-749)+(2.021)+(16.007), (I-749)+(2.021)+(16.008), (I-749)+(2.021)+(17.001), (I-749)+(2.021)+(17.002), (I-749)+(2.021)+(17.003), (I-749)+(2.021)+(17.004), (I-749)+(2.021)+(17.005), (I-749)+(2.021)+(17.006), (I-749)+(2.021)+(17.007), (I-749)+(2.021)+(17.008), (I-749)+(2.021)+(17.009), (I-749)+(2.021)+(17.010), (I-749)+(2.021)+(17.011), (I-749)+(2.021)+(17.012), (I-749)+(2.021)+(18.001),

(I-749)+(2.022)+(3.001), (I-749)+(2.022)+(3.002), (I-749)+(2.022)+(3.003), (I-749)+(2.022)+(3.004), (I-749)+(2.022)+(3.005), (I-749)+(2.022)+(3.006), (I-749)+(2.022)+(3.007), (I-749)+(2.022)+(3.008), (I-749)+(2.022)+(3.009), (I-749)+(2.022)+(3.010), (I-749)+(2.022)+(3.011), (I-749)+(2.022)+(3.012), (I-749)+(2.022)+(3.013), (I-749)+(2.022)+(3.014), (I-749)+(2.022)+(3.015), (I-749)+(2.022)+(3.016), (I-749)+(2.022)+(3.017), (I-749)+(2.022)+(3.018), (I-749)+(2.022)+(3.019), (I-749)+(2.022)+(3.020), (I-749)+(2.022)+(3.021), (I-749)+(2.022)+(3.022), (I-749)+(2.022)+(3.023), (I-749)+(2.022)+(3.024), (I-749)+(2.022)+(3.025), (I-749)+(2.022)+(3.026), (I-749)+(2.022)+(3.027), (I-749)+(2.022)+(3.028), (I-749)+(2.022)+(3.029), (I-749)+(2.022)+(3.030), (I-749)+(2.022)+(3.031), (I-749)+(2.022)+(5.001), (I-749)+(2.022)+(5.002), (I-749)+(2.022)+(5.003), (I-749)+(2.022)+(5.004), (I-749)+(2.022)+(5.005), (I-749)+(2.022)+(5.006), (I-749)+(2.022)+(5.007), (I-749)+(2.022)+(5.008), (I-749)+(2.022)+(5.009), (I-749)+(2.022)+(5.010), (I-749)+(2.022)+(5.011), (I-749)+(2.022)+(5.012), (I-749)+(2.022)+(5.013), (I-749)+(2.022)+(5.014), (I-749)+(2.022)+(5.015), (I-749)+(2.022)+(5.016), (I-749)+(2.022)+(5.017), (I-749)+(2.022)+(5.018), (I-749)+(2.022)+(5.019), (I-749)+(2.022)+(5.020), (I-749)+(2.022)+(5.021), (I-749)+(2.022)+(5.022), (I-749)+(2.022)+(5.023), (I-749)+(2.022)+(6.001), (I-749)+(2.022)+(6.002), (I-749)+(2.022)+(6.003), (I-749)+(2.022)+(6.004), (I-749)+(2.022)+(7.001), (I-749)+(2.022)+(7.002), (I-749)+(2.022)+(7.003), (I-749)+(2.022)+(7.004), (I-749)+(2.022)+(7.005), (I-749)+(2.022)+(7.006), (I-749)+(2.022)+(9.001), (I-749)+(2.022)+(9.002), (I-749)+(2.022)+(9.003), (I-749)+(2.022)+(9.004), (I-749)+(2.022)+(9.005), (I-749)+(2.022)+(9.006), (I-749)+(2.022)+(9.007), (I-749)+(2.022)+(9.008), (I-749)+(2.022)+(9.009), (I-749)+(2.022)+(14.001), (I-749)+(2.022)+(14.002), (I-749)+(2.022)+(15.008), (I-749)+(2.022)+(15.011), (I-749)+(2.022)+(15.012), (I-749)+(2.022)+(15.016), (I-749)+(2.022)+(15.025), (I-749)+(2.022)+(15.027), (I-749)+(2.022)+(15.047), (I-749)+(2.022)+(15.063), (I-749)+(2.022)+(15.064), (I-749)+(2.022)+(16.001), (I-749)+(2.022)+(16.002), (I-749)+(2.022)+(16.003), (I-749)+(2.022)+(16.004), (I-749)+(2.022)+(16.005), (I-749)+(2.022)+(16.006), (I-749)+(2.022)+(16.007), (I-749)+(2.022)+(16.008), (I-749)+(2.022)+(17.001), (I-749)+(2.022)+(17.002), (I-749)+(2.022)+(17.003), (I-749)+(2.022)+(17.004), (I-749)+(2.022)+(17.005), (I-749)+(2.022)+(17.006), (I-749)+(2.022)+(17.007), (I-749)+(2.022)+(17.008), (I-749)+(2.022)+(17.009), (I-749)+(2.022)+(17.010), (I-749)+(2.022)+(17.011), (I-749)+(2.022)+(17.012), (I-749)+(2.022)+(18.001),

(I-749)+(2.023)+(3.001), (I-749)+(2.023)+(3.002), (I-749)+(2.023)+(3.003), (I-749)+(2.023)+(3.004), (I-749)+(2.023)+(3.005), (I-749)+(2.023)+(3.006), (I-749)+(2.023)+(3.007), (I-749)+(2.023)+(3.008), (I-749)+(2.023)+(3.009), (I-749)+(2.023)+(3.010), (I-749)+(2.023)+(3.011), (I-749)+(2.023)+(3.012), (I-749)+(2.023)+(3.013), (I-749)+(2.023)+(3.014), (I-749)+(2.023)+(3.015), (I-749)+(2.023)+(3.016), (I-749)+(2.023)+(3.017), (I-749)+(2.023)+(3.018), (I-749)+(2.023)+(3.019), (I-749)+(2.023)+(3.020), (I-749)+(2.023)+(3.021), (I-749)+(2.023)+(3.022), (I-749)+(2.023)+(3.023), (I-749)+(2.023)+(3.024), (I-749)+(2.023)+(3.025), (I-749)+(2.023)+(3.026), (I-749)+(2.023)+(3.027), (I-749)+(2.023)+(3.028), (I-749)+(2.023)+(3.029), (I-749)+(2.023)+(3.030), (I-749)+(2.023)+(3.031), (I-749)+(2.023)+(5.001), (I-749)+(2.023)+(5.002), (I-749)+(2.023)+(5.003), (I-749)+(2.023)+(5.004), (I-749)+(2.023)+(5.005), (I-749)+(2.023)+(5.006), (I-749)+(2.023)+(5.007), (I-749)+(2.023)+(5.008), (I-749)+(2.023)+(5.009), (I-749)+(2.023)+(5.010), (I-749)+(2.023)+(5.011), (I-749)+(2.023)+(5.012), (I-749)+(2.023)+(5.013), (I-749)+(2.023)+(5.014), (I-749)+(2.023)+(5.015), (I-749)+(2.023)+(5.016), (I-749)+(2.023)+(5.017), (I-749)+(2.023)+(5.018), (I-749)+(2.023)+(5.019), (I-749)+(2.023)+(5.020), (I-749)+(2.023)+(5.021), (I-749)+(2.023)+(5.022), (I-749)+(2.023)+(5.023), (I-749)+(2.023)+(6.001), (I-749)+(2.023)+(6.002), (I-749)+(2.023)+(6.003), (I-749)+(2.023)+(6.004), (I-749)+(2.023)+(7.001), (I-749)+(2.023)+(7.002), (I-749)+(2.023)+(7.003), (I-749)+(2.023)+(7.004), (I-749)+(2.023)+(7.005), (I-749)+(2.023)+(7.006), (I-749)+(2.023)+(9.001), (I-749)+(2.023)+(9.002), (I-749)+(2.023)+(9.003), (I-749)+(2.023)+(9.004), (I-749)+(2.023)+(9.005), (I-749)+(2.023)+(9.006), (I-749)+(2.023)+(9.007), (I-749)+(2.023)+(9.008), (I-749)+(2.023)+(9.009), (I-749)+(2.023)+(14.001), (I-749)+(2.023)+(14.002), (I-749)+(2.023)+(15.008), (I-749)+(2.023)+(15.011), (I-749)+(2.023)+(15.012), (I-749)+(2.023)+(15.016), (I-749)+(2.023)+(15.025), (I-749)+(2.023)+(15.027), (I-749)+(2.023)+(15.047), (I-749)+(2.023)+(15.063), (I-749)+(2.023)+(15.064), (I-749)+(2.023)+(16.001), (I-749)+(2.023)+(16.002), (I-749)+(2.023)+(16.003), (I-749)+(2.023)+(16.004), (I-749)+(2.023)+(16.005), (I-749)+(2.023)+(16.006), (I-749)+(2.023)+(16.007), (I-749)+(2.023)+(16.008), (I-749)+(2.023)+(17.001), (I-749)+(2.023)+(17.002), (I-749)+(2.023)+(17.003), (I-749)+(2.023)+(17.004), (I-749)+(2.023)+(17.005), (I-749)+(2.023)+(17.006), (I-749)+(2.023)+(17.007), (I-749)+(2.023)+(17.008), (I-749)+(2.023)+(17.009), (I-749)+(2.023)+(17.010), (I-749)+(2.023)+(17.011), (I-749)+(2.023)+(17.012), (I-749)+(2.023)+(18.001),

(I-749)+(2.024)+(3.001), (I-749)+(2.024)+(3.002), (I-749)+(2.024)+(3.003), (I-749)+(2.024)+(3.004), (I-749)+(2.024)+(3.005), (I-749)+(2.024)+(3.006), (I-749)+(2.024)+(3.007), (I-749)+(2.024)+(3.008), (I-749)+(2.024)+(3.009), (I-749)+(2.024)+(3.010), (I-749)+(2.024)+(3.011), (I-749)+(2.024)+(3.012), (I-749)+(2.024)+(3.013), (I-749)+(2.024)+(3.014), (I-749)+(2.024)+(3.015), (I-749)+(2.024)+(3.016), (I-749)+(2.024)+(3.017), (I-749)+(2.024)+(3.018), (I-749)+(2.024)+(3.019), (I-749)+(2.024)+(3.020), (I-749)+(2.024)+(3.021), (I-749)+(2.024)+(3.022), (I-749)+(2.024)+(3.023), (I-749)+(2.024)+(3.024), (I-749)+(2.024)+(3.025), (I-749)+(2.024)+(3.026), (I-749)+(2.024)+(3.027), (I-749)+(2.024)+(3.028), (I-749)+(2.024)+(3.029), (I-749)+(2.024)+(3.030), (I-749)+(2.024)+(3.031), (I-749)+(2.024)+(5.001), (I-749)+(2.024)+(5.002), (I-749)+(2.024)+(5.003), (I-749)+(2.024)+(5.004), (I-749)+(2.024)+(5.005), (I-749)+(2.024)+(5.006), (I-749)+(2.024)+(5.007), (I-749)+(2.024)+(5.008), (I-749)+(2.024)+(5.009), (I-749)+(2.024)+(5.010), (I-749)+(2.024)+(5.011), (I-749)+(2.024)+(5.012), (I-749)+(2.024)+(5.013), (I-749)+(2.024)+(5.014), (I-749)+(2.024)+(5.015), (I-749)+(2.024)+(5.016), (I-749)+(2.024)+(5.017), (I-749)+(2.024)+(5.018), (I-749)+(2.024)+(5.019), (I-749)+(2.024)+(5.020), (I-749)+(2.024)+(5.021), (I-749)+(2.024)+(5.022), (I-749)+(2.024)+(5.023), (I-749)+(2.024)+(6.001), (I-749)+(2.024)+(6.002), (I-749)+(2.024)+(6.003), (I-749)+(2.024)+(6.004), (I-749)+(2.024)+(7.001), (I-749)+(2.024)+(7.002), (I-749)+(2.024)+(7.003), (I-749)+(2.024)+(7.004), (I-749)+(2.024)+(7.005), (I-749)+(2.024)+(7.006), (I-749)+(2.024)+(9.001), (I-749)+(2.024)+(9.002), (I-749)+(2.024)+(9.003), (I-749)+(2.024)+(9.004), (I-749)+(2.024)+(9.005), (I-749)+(2.024)+(9.006), (I-749)+(2.024)+(9.007), (I-749)+(2.024)+(9.008), (I-749)+(2.024)+(9.009), (I-749)+(2.024)+(14.001), (I-749)+(2.024)+(14.002), (I-749)+(2.024)+(15.008), (I-749)+(2.024)+(15.011), (I-749)+(2.024)+(15.012), (I-749)+(2.024)+(15.016), (I-749)+(2.024)+(15.025), (I-749)+(2.024)+(15.027), (I-749)+(2.024)+(15.047), (I-749)+(2.024)+(15.063), (I-749)+(2.024)+(15.064), (I-749)+(2.024)+(16.001), (I-749)+(2.024)+(16.002), (I-749)+(2.024)+(16.003), (I-749)+(2.024)+(16.004), (I-749)+(2.024)+(16.005), (I-749)+(2.024)+(16.006), (I-749)+(2.024)+(16.007), (I-749)+(2.024)+(16.008), (I-749)+(2.024)+(17.001), (I-749)+(2.024)+(17.002), (I-749)+(2.024)+(17.003), (I-749)+(2.024)+(17.004), (I-749)+(2.024)+(17.005), (I-749)+(2.024)+(17.006), (I-749)+(2.024)+(17.007), (I-749)+(2.024)+(17.008), (I-749)+(2.024)+(17.009), (I-749)+(2.024)+(17.010), (I-749)+(2.024)+(17.011), (I-749)+(2.024)+(17.012), (I-749)+(2.024)+(18.001),

(I-749)+(2.025)+(3.001), (I-749)+(2.025)+(3.002), (I-749)+(2.025)+(3.003), (I-749)+(2.025)+(3.004), (I-749)+(2.025)+(3.005), (I-749)+(2.025)+(3.006), (I-749)+(2.025)+(3.007), (I-749)+(2.025)+(3.008), (I-749)+(2.025)+(3.009), (I-749)+(2.025)+(3.010), (I-749)+(2.025)+(3.011), (I-749)+(2.025)+(3.012), (I-749)+(2.025)+(3.013), (I-749)+(2.025)+(3.014), (I-749)+(2.025)+(3.015), (I-749)+(2.025)+(3.016), (I-749)+(2.025)+(3.017), (I-749)+(2.025)+(3.018), (I-749)+(2.025)+(3.019), (I-749)+(2.025)+(3.020), (I-749)+(2.025)+(3.021), (I-749)+(2.025)+(3.022), (I-749)+(2.025)+(3.023), (I-749)+(2.025)+(3.024), (I-749)+(2.025)+(3.025), (I-749)+(2.025)+(3.026), (I-749)+(2.025)+(3.027), (I-749)+(2.025)+(3.028), (I-749)+(2.025)+(3.029), (I-749)+(2.025)+(3.030), (I-749)+(2.025)+(3.031), (I-749)+(2.025)+(5.001), (I-749)+(2.025)+(5.002), (I-749)+(2.025)+(5.003), (I-749)+(2.025)+(5.004), (I-749)+(2.025)+(5.005), (I-749)+(2.025)+(5.006), (I-749)+(2.025)+(5.007), (I-749)+(2.025)+(5.008), (I-749)+(2.025)+(5.009), (I-749)+(2.025)+(5.010), (I-749)+(2.025)+(5.011), (I-749)+(2.025)+(5.012), (I-749)+(2.025)+(5.013), (I-749)+(2.025)+(5.014), (I-749)+(2.025)+(5.015), (I-749)+(2.025)+(5.016), (I-749)+(2.025)+(5.017), (I-749)+(2.025)+(5.018), (I-749)+(2.025)+(5.019), (I-749)+(2.025)+(5.020), (I-749)+(2.025)+(5.021), (I-749)+(2.025)+(5.022), (I-749)+(2.025)+(5.023), (I-749)+(2.025)+(6.001), (I-749)+(2.025)+(6.002), (I-749)+(2.025)+(6.003), (I-749)+(2.025)+(6.004), (I-749)+(2.025)+(7.001), (I-749)+(2.025)+(7.002), (I-749)+(2.025)+(7.003), (I-749)+(2.025)+(7.004), (I-749)+(2.025)+(7.005), (I-749)+(2.025)+(7.006), (I-749)+(2.025)+(9.001), (I-749)+(2.025)+(9.002), (I-749)+(2.025)+(9.003), (I-749)+(2.025)+(9.004), (I-749)+(2.025)+(9.005), (I-749)+(2.025)+(9.006), (I-749)+(2.025)+(9.007), (I-749)+(2.025)+(9.008), (I-749)+(2.025)+(9.009), (I-749)+(2.025)+(14.001), (I-749)+(2.025)+(14.002), (I-749)+(2.025)+(15.008), (I-749)+(2.025)+(15.011), (I-749)+(2.025)+(15.012), (I-749)+(2.025)+(15.016), (I-749)+(2.025)+(15.025), (I-749)+(2.025)+(15.027), (I-749)+(2.025)+(15.047), (I-749)+(2.025)+(15.063), (I-749)+(2.025)+(15.064), (I-749)+(2.025)+(16.001), (I-749)+(2.025)+(16.002), (I-749)+(2.025)+(16.003), (I-749)+(2.025)+(16.004), (I-749)+(2.025)+(16.005), (I-749)+(2.025)+(16.006), (I-749)+(2.025)+(16.007), (I-749)+(2.025)+(16.008), (I-749)+(2.025)+(17.001), (I-749)+(2.025)+(17.002), (I-749)+(2.025)+(17.003), (I-749)+(2.025)+(17.004), (I-749)+(2.025)+(17.005), (I-749)+(2.025)+(17.006), (I-749)+(2.025)+(17.007), (I-749)+(2.025)+(17.008), (I-749)+(2.025)+(17.009), (I-749)+(2.025)+(17.010), (I-749)+(2.025)+(17.011), (I-749)+(2.025)+(17.012), (I-749)+(2.025)+(18.001),

(I-749)+(2.026)+(3.001), (I-749)+(2.026)+(3.002), (I-749)+(2.026)+(3.003), (I-749)+(2.026)+(3.004), (I-749)+(2.026)+(3.005), (I-749)+(2.026)+(3.006), (I-749)+(2.026)+(3.007), (I-749)+(2.026)+(3.008), (I-749)+(2.026)+(3.009), (I-749)+(2.026)+(3.010), (I-749)+(2.026)+(3.011), (I-749)+(2.026)+(3.012), (I-749)+(2.026)+(3.013), (I-749)+(2.026)+(3.014), (I-749)+(2.026)+(3.015), (I-749)+(2.026)+(3.016), (I-749)+(2.026)+(3.017), (I-749)+(2.026)+(3.018), (I-749)+(2.026)+(3.019), (I-749)+(2.026)+(3.020), (I-749)+(2.026)+(3.021), (I-749)+(2.026)+(3.022), (I-749)+(2.026)+(3.023), (I-749)+(2.026)+(3.024), (I-749)+(2.026)+(3.025), (I-749)+(2.026)+(3.026), (I-749)+(2.026)+(3.027), (I-749)+(2.026)+(3.028), (I-749)+(2.026)+(3.029), (I-749)+(2.026)+(3.030), (I-749)+(2.026)+(3.031), (I-749)+(2.026)+(5.001), (I-749)+(2.026)+(5.002), (I-749)+(2.026)+(5.003), (I-749)+(2.026)+(5.004), (I-749)+(2.026)+(5.005), (I-749)+(2.026)+(5.006), (I-749)+(2.026)+(5.007), (I-749)+(2.026)+(5.008), (I-749)+(2.026)+(5.009), (I-749)+(2.026)+(5.010), (I-749)+(2.026)+(5.011), (I-749)+(2.026)+(5.012), (I-749)+(2.026)+(5.013), (I-749)+(2.026)+(5.014), (I-749)+(2.026)+(5.015), (I-749)+(2.026)+(5.016), (I-749)+(2.026)+(5.017), (I-749)+(2.026)+(5.018), (I-749)+(2.026)+(5.019), (I-749)+(2.026)+(5.020), (I-749)+(2.026)+(5.021), (I-749)+(2.026)+(5.022), (I-749)+(2.026)+(5.023), (I-749)+(2.026)+(6.001), (I-749)+(2.026)+(6.002), (I-749)+(2.026)+(6.003), (I-749)+(2.026)+(6.004), (I-749)+(2.026)+(7.001), (I-749)+(2.026)+(7.002), (I-749)+(2.026)+(7.003), (I-749)+(2.026)+(7.004), (I-749)+(2.026)+(7.005), (I-749)+(2.026)+(7.006), (I-749)+(2.026)+(9.001), (I-749)+(2.026)+(9.002), (I-749)+(2.026)+(9.003), (I-749)+(2.026)+(9.004), (I-749)+(2.026)+(9.005), (I-749)+(2.026)+(9.006), (I-749)+(2.026)+(9.007), (I-749)+(2.026)+(9.008), (I-749)+(2.026)+(9.009), (I-749)+(2.026)+(14.001), (I-749)+(2.026)+(14.002), (I-749)+(2.026)+(15.008), (I-749)+(2.026)+(15.011), (I-749)+(2.026)+(15.012), (I-749)+(2.026)+(15.016), (I-749)+(2.026)+(15.025), (I-749)+(2.026)+(15.027), (I-749)+(2.026)+(15.047), (I-749)+(2.026)+(15.063), (I-749)+(2.026)+(15.064), (I-749)+(2.026)+(16.001), (I-749)+(2.026)+(16.002), (I-749)+(2.026)+(16.003), (I-749)+(2.026)+(16.004), (I-749)+(2.026)+(16.005), (I-749)+(2.026)+(16.006), (I-749)+(2.026)+(16.007), (I-749)+(2.026)+(16.008), (I-749)+(2.026)+(17.001), (I-749)+(2.026)+(17.002), (I-749)+(2.026)+(17.003), (I-749)+(2.026)+(17.004), (I-749)+(2.026)+(17.005), (I-749)+(2.026)+(17.006), (I-749)+(2.026)+(17.007), (I-749)+(2.026)+(17.008), (I-749)+(2.026)+(17.009), (I-749)+(2.026)+(17.010), (I-749)+(2.026)+(17.011), (I-749)+(2.026)+(17.012), (I-749)+(2.026)+(18.001),

(I-749)+(2.027)+(3.001), (I-749)+(2.027)+(3.002), (I-749)+(2.027)+(3.003), (I-749)+(2.027)+(3.004), (I-749)+(2.027)+(3.005), (I-749)+(2.027)+(3.006), (I-749)+(2.027)+(3.007), (I-749)+(2.027)+(3.008), (I-749)+(2.027)+(3.009), (I-749)+(2.027)+(3.010), (I-749)+(2.027)+(3.011), (I-749)+(2.027)+(3.012), (I-749)+(2.027)+(3.013), (I-749)+(2.027)+(3.014), (I-749)+(2.027)+(3.015), (I-749)+(2.027)+(3.016), (I-749)+(2.027)+(3.017), (I-749)+(2.027)+(3.018), (I-749)+(2.027)+(3.019), (I-749)+(2.027)+(3.020), (I-749)+(2.027)+(3.021), (I-749)+(2.027)+(3.022), (I-749)+(2.027)+(3.023), (I-749)+(2.027)+(3.024), (I-749)+(2.027)+(3.025), (I-749)+(2.027)+(3.026), (I-749)+(2.027)+(3.027), (I-749)+(2.027)+(3.028), (I-749)+(2.027)+(3.029), (I-749)+(2.027)+(3.030), (I-749)+(2.027)+(3.031), (I-749)+(2.027)+(5.001), (I-749)+(2.027)+(5.002), (I-749)+(2.027)+(5.003), (I-749)+(2.027)+(5.004), (I-749)+(2.027)+(5.005), (I-749)+(2.027)+(5.006), (I-749)+(2.027)+(5.007), (I-749)+(2.027)+(5.008), (I-749)+(2.027)+(5.009), (I-749)+(2.027)+(5.010), (I-749)+(2.027)+(5.011), (I-749)+(2.027)+(5.012), (I-749)+(2.027)+(5.013), (I-749)+(2.027)+(5.014), (I-749)+(2.027)+(5.015), (I-749)+(2.027)+(5.016), (I-749)+(2.027)+(5.017), (I-749)+(2.027)+(5.018), (I-749)+(2.027)+(5.019), (I-749)+(2.027)+(5.020), (I-749)+(2.027)+(5.021), (I-749)+(2.027)+(5.022), (I-749)+(2.027)+(5.023), (I-749)+(2.027)+(6.001), (I-749)+(2.027)+(6.002), (I-749)+(2.027)+(6.003), (I-749)+(2.027)+(6.004), (I-749)+(2.027)+(7.001), (I-749)+(2.027)+(7.002), (I-749)+(2.027)+(7.003), (I-749)+(2.027)+(7.004), (I-749)+(2.027)+(7.005), (I-749)+(2.027)+(7.006), (I-749)+(2.027)+(9.001), (I-749)+(2.027)+(9.002), (I-749)+(2.027)+(9.003), (I-749)+(2.027)+(9.004), (I-749)+(2.027)+(9.005), (I-749)+(2.027)+(9.006), (I-749)+(2.027)+(9.007), (I-749)+(2.027)+(9.008), (I-749)+(2.027)+(9.009), (I-749)+(2.027)+(14.001), (I-749)+(2.027)+(14.002), (I-749)+(2.027)+(15.008), (I-749)+(2.027)+(15.011), (I-749)+(2.027)+(15.012), (I-749)+(2.027)+(15.016), (I-749)+(2.027)+(15.025), (I-749)+(2.027)+(15.027), (I-749)+(2.027)+(15.047), (I-749)+(2.027)+(15.063), (I-749)+(2.027)+(15.064), (I-749)+(2.027)+(16.001), (I-749)+(2.027)+(16.002), (I-749)+(2.027)+(16.003), (I-749)+(2.027)+(16.004), (I-749)+(2.027)+(16.005), (I-749)+(2.027)+(16.006), (I-749)+(2.027)+(16.007), (I-749)+(2.027)+(16.008), (I-749)+(2.027)+(17.001), (I-749)+(2.027)+(17.002), (I-749)+(2.027)+(17.003), (I-749)+(2.027)+(17.004), (I-749)+(2.027)+(17.005), (I-749)+(2.027)+(17.006), (I-749)+(2.027)+(17.007), (I-749)+(2.027)+(17.008), (I-749)+(2.027)+(17.009), (I-749)+(2.027)+(17.010), (I-749)+(2.027)+(17.011), (I-749)+(2.027)+(17.012), (I-749)+(2.027)+(18.001),

(I-749)+(2.028)+(3.001), (I-749)+(2.028)+(3.002), (I-749)+(2.028)+(3.003), (I-749)+(2.028)+(3.004), (I-749)+(2.028)+(3.005), (I-749)+(2.028)+(3.006), (I-749)+(2.028)+(3.007), (I-749)+(2.028)+(3.008), (I-749)+(2.028)+(3.009), (I-749)+(2.028)+(3.010), (I-749)+(2.028)+(3.011), (I-749)+(2.028)+(3.012), (I-749)+(2.028)+(3.013), (I-749)+(2.028)+(3.014), (I-749)+(2.028)+(3.015), (I-749)+(2.028)+(3.016), (I-749)+(2.028)+(3.017), (I-749)+(2.028)+(3.018), (I-749)+(2.028)+(3.019), (I-749)+(2.028)+(3.020), (I-749)+(2.028)+(3.021), (I-749)+(2.028)+(3.022), (I-749)+(2.028)+(3.023), (I-749)+(2.028)+(3.024), (I-749)+(2.028)+(3.025), (I-749)+(2.028)+(3.026), (I-749)+(2.028)+(3.027), (I-749)+(2.028)+(3.028), (I-749)+(2.028)+(3.029), (I-749)+(2.028)+(3.030), (I-749)+(2.028)+(3.031), (I-749)+(2.028)+(5.001), (I-749)+(2.028)+(5.002), (I-749)+(2.028)+(5.003), (I-749)+(2.028)+(5.004), (I-749)+(2.028)+(5.005), (I-749)+(2.028)+(5.006), (I-749)+(2.028)+(5.007), (I-749)+(2.028)+(5.008), (I-749)+(2.028)+(5.009), (I-749)+(2.028)+(5.010), (I-749)+(2.028)+(5.011), (I-749)+(2.028)+(5.012), (I-749)+(2.028)+(5.013), (I-749)+(2.028)+(5.014), (I-749)+(2.028)+(5.015), (I-749)+(2.028)+(5.016), (I-749)+(2.028)+(5.017), (I-749)+(2.028)+(5.018), (I-749)+(2.028)+(5.019), (I-749)+(2.028)+(5.020), (I-749)+(2.028)+(5.021), (I-749)+(2.028)+(5.022), (I-749)+(2.028)+(5.023), (I-749)+(2.028)+(6.001), (I-749)+(2.028)+(6.002), (I-749)+(2.028)+(6.003), (I-749)+(2.028)+(6.004), (I-749)+(2.028)+(7.001), (I-749)+(2.028)+(7.002), (I-749)+(2.028)+(7.003), (I-749)+(2.028)+(7.004), (I-749)+(2.028)+(7.005), (I-749)+(2.028)+(7.006), (I-749)+(2.028)+(9.001), (I-749)+(2.028)+(9.002), (I-749)+(2.028)+(9.003), (I-749)+(2.028)+(9.004), (I-749)+(2.028)+(9.005), (I-749)+(2.028)+(9.006), (I-749)+(2.028)+(9.007), (I-749)+(2.028)+(9.008), (I-749)+(2.028)+(9.009), (I-749)+(2.028)+(14.001), (I-749)+(2.028)+(14.002), (I-749)+(2.028)+(15.008), (I-749)+(2.028)+(15.011), (I-749)+(2.028)+(15.012), (I-749)+(2.028)+(15.016), (I-749)+(2.028)+(15.025), (I-749)+(2.028)+(15.027), (I-749)+(2.028)+(15.047), (I-749)+(2.028)+(15.063), (I-749)+(2.028)+(15.064), (I-749)+(2.028)+(16.001), (I-749)+(2.028)+(16.002), (I-749)+(2.028)+(16.003), (I-749)+(2.028)+(16.004), (I-749)+(2.028)+(16.005), (I-749)+(2.028)+(16.006), (I-749)+(2.028)+(16.007), (I-749)+(2.028)+(16.008), (I-749)+(2.028)+(17.001), (I-749)+(2.028)+(17.002), (I-749)+(2.028)+(17.003), (I-749)+(2.028)+(17.004), (I-749)+(2.028)+(17.005), (I-749)+(2.028)+(17.006), (I-749)+(2.028)+(17.007), (I-749)+(2.028)+(17.008), (I-749)+(2.028)+(17.009), (I-749)+(2.028)+(17.010), (I-749)+(2.028)+(17.011), (I-749)+(2.028)+(17.012), (I-749)+(2.028)+(18.001),

(I-749)+(2.029)+(3.001), (I-749)+(2.029)+(3.002), (I-749)+(2.029)+(3.003), (I-749)+(2.029)+(3.004), (I-749)+(2.029)+(3.005), (I-749)+(2.029)+(3.006), (I-749)+(2.029)+(3.007), (I-749)+(2.029)+(3.008), (I-749)+(2.029)+(3.009), (I-749)+(2.029)+(3.010), (I-749)+(2.029)+(3.011), (I-749)+(2.029)+(3.012), (I-749)+(2.029)+(3.013), (I-749)+(2.029)+(3.014), (I-749)+(2.029)+(3.015), (I-749)+(2.029)+(3.016), (I-749)+(2.029)+(3.017), (I-749)+(2.029)+(3.018), (I-749)+(2.029)+(3.019), (I-749)+(2.029)+(3.020), (I-749)+(2.029)+(3.021), (I-749)+(2.029)+(3.022), (I-749)+(2.029)+(3.023), (I-749)+(2.029)+(3.024), (I-749)+(2.029)+(3.025), (I-749)+(2.029)+(3.026), (I-749)+(2.029)+(3.027), (I-749)+(2.029)+(3.028), (I-749)+(2.029)+(3.029), (I-749)+(2.029)+(3.030), (I-749)+(2.029)+(3.031), (I-749)+(2.029)+(5.001), (I-749)+(2.029)+(5.002), (I-749)+(2.029)+(5.003), (I-749)+(2.029)+(5.004), (I-749)+(2.029)+(5.005), (I-749)+(2.029)+(5.006), (I-749)+(2.029)+(5.007), (I-749)+(2.029)+(5.008), (I-749)+(2.029)+(5.009), (I-749)+(2.029)+(5.010), (I-749)+(2.029)+(5.011), (I-749)+(2.029)+(5.012), (I-749)+(2.029)+(5.013), (I-749)+(2.029)+(5.014), (I-749)+(2.029)+(5.015), (I-749)+(2.029)+(5.016), (I-749)+(2.029)+(5.017), (I-749)+(2.029)+(5.018), (I-749)+(2.029)+(5.019), (I-749)+(2.029)+(5.020), (I-749)+(2.029)+(5.021), (I-749)+(2.029)+(5.022), (I-749)+(2.029)+(5.023), (I-749)+(2.029)+(6.001), (I-749)+(2.029)+(6.002), (I-749)+(2.029)+(6.003), (I-749)+(2.029)+(6.004), (I-749)+(2.029)+(7.001), (I-749)+(2.029)+(7.002), (I-749)+(2.029)+(7.003), (I-749)+(2.029)+(7.004), (I-749)+(2.029)+(7.005), (I-749)+(2.029)+(7.006), (I-749)+(2.029)+(9.001), (I-749)+(2.029)+(9.002), (I-749)+(2.029)+(9.003), (I-749)+(2.029)+(9.004), (I-749)+(2.029)+(9.005), (I-749)+(2.029)+(9.006), (I-749)+(2.029)+(9.007), (I-749)+(2.029)+(9.008), (I-749)+(2.029)+(9.009), (I-749)+(2.029)+(14.001), (I-749)+(2.029)+(14.002), (I-749)+(2.029)+(15.008), (I-749)+(2.029)+(15.011), (I-749)+(2.029)+(15.012), (I-749)+(2.029)+(15.016), (I-749)+(2.029)+(15.025), (I-749)+(2.029)+(15.027), (I-749)+(2.029)+(15.047), (I-749)+(2.029)+(15.063), (I-749)+(2.029)+(15.064), (I-749)+(2.029)+(16.001), (I-749)+(2.029)+(16.002), (I-749)+(2.029)+(16.003), (I-749)+(2.029)+(16.004), (I-749)+(2.029)+(16.005), (I-749)+(2.029)+(16.006), (I-749)+(2.029)+(16.007), (I-749)+(2.029)+(16.008), (I-749)+(2.029)+(17.001), (I-749)+(2.029)+(17.002), (I-749)+(2.029)+(17.003), (I-749)+(2.029)+(17.004), (I-749)+(2.029)+(17.005), (I-749)+(2.029)+(17.006), (I-749)+(2.029)+(17.007), (I-749)+(2.029)+(17.008), (I-749)+(2.029)+(17.009), (I-749)+(2.029)+(17.010), (I-749)+(2.029)+(17.011), (I-749)+(2.029)+(17.012), (I-749)+(2.029)+(18.001),

(I-749)+(2.030)+(3.001), (I-749)+(2.030)+(3.002), (I-749)+(2.030)+(3.003), (I-749)+(2.030)+(3.004), (I-749)+(2.030)+(3.005), (I-749)+(2.030)+(3.006), (I-749)+(2.030)+(3.007), (I-749)+(2.030)+(3.008), (I-749)+(2.030)+(3.009), (I-749)+(2.030)+(3.010), (I-749)+(2.030)+(3.011), (I-749)+(2.030)+(3.012), (I-749)+(2.030)+(3.013), (I-749)+(2.030)+(3.014), (I-749)+(2.030)+(3.015), (I-749)+(2.030)+(3.016), (I-749)+(2.030)+(3.017), (I-749)+(2.030)+(3.018), (I-749)+(2.030)+(3.019), (I-749)+(2.030)+(3.020), (I-749)+(2.030)+(3.021), (I-749)+(2.030)+(3.022), (I-749)+(2.030)+(3.023), (I-749)+(2.030)+(3.024), (I-749)+(2.030)+(3.025), (I-749)+(2.030)+(3.026), (I-749)+(2.030)+(3.027), (I-749)+(2.030)+(3.028), (I-749)+(2.030)+(3.029), (I-749)+(2.030)+(3.030), (I-749)+(2.030)+(3.031), (I-749)+(2.030)+(5.001), (I-749)+(2.030)+(5.002), (I-749)+(2.030)+(5.003), (I-749)+(2.030)+(5.004), (I-749)+(2.030)+(5.005), (I-749)+(2.030)+(5.006), (I-749)+(2.030)+(5.007), (I-749)+(2.030)+(5.008), (I-749)+(2.030)+(5.009), (I-749)+(2.030)+(5.010), (I-749)+(2.030)+(5.011), (I-749)+(2.030)+(5.012), (I-749)+(2.030)+(5.013), (I-749)+(2.030)+(5.014), (I-749)+(2.030)+(5.015), (I-749)+(2.030)+(5.016), (I-749)+(2.030)+(5.017), (I-749)+(2.030)+(5.018), (I-749)+(2.030)+(5.019), (I-749)+(2.030)+(5.020), (I-749)+(2.030)+(5.021), (I-749)+(2.030)+(5.022), (I-749)+(2.030)+(5.023), (I-749)+(2.030)+(6.001), (I-749)+(2.030)+(6.002), (I-749)+(2.030)+(6.003), (I-749)+(2.030)+(6.004), (I-749)+(2.030)+(7.001), (I-749)+(2.030)+(7.002), (I-749)+(2.030)+(7.003), (I-749)+(2.030)+(7.004), (I-749)+(2.030)+(7.005), (I-749)+(2.030)+(7.006), (I-749)+(2.030)+(9.001), (I-749)+(2.030)+(9.002), (I-749)+(2.030)+(9.003), (I-749)+(2.030)+(9.004), (I-749)+(2.030)+(9.005), (I-749)+(2.030)+(9.006), (I-749)+(2.030)+(9.007), (I-749)+(2.030)+(9.008), (I-749)+(2.030)+(9.009), (I-749)+(2.030)+(14.001), (I-749)+(2.030)+(14.002), (I-749)+(2.030)+(15.008), (I-749)+(2.030)+(15.011), (I-749)+(2.030)+(15.012), (I-749)+(2.030)+(15.016), (I-749)+(2.030)+(15.025), (I-749)+(2.030)+(15.027), (I-749)+(2.030)+(15.047), (I-749)+(2.030)+(15.063), (I-749)+(2.030)+(15.064), (I-749)+(2.030)+(16.001), (I-749)+(2.030)+(16.002), (I-749)+(2.030)+(16.003), (I-749)+(2.030)+(16.004), (I-749)+(2.030)+(16.005), (I-749)+(2.030)+(16.006), (I-749)+(2.030)+(16.007), (I-749)+(2.030)+(16.008), (I-749)+(2.030)+(17.001), (I-749)+(2.030)+(17.002), (I-749)+(2.030)+(17.003), (I-749)+(2.030)+(17.004), (I-749)+(2.030)+(17.005), (I-749)+(2.030)+(17.006), (I-749)+(2.030)+(17.007), (I-749)+(2.030)+(17.008), (I-749)+(2.030)+(17.009), (I-749)+(2.030)+(17.010), (I-749)+(2.030)+(17.011), (I-749)+(2.030)+(17.012), (I-749)+(2.030)+(18.001),

(I-749)+(2.031)+(3.001), (I-749)+(2.031)+(3.002), (I-749)+(2.031)+(3.003), (I-749)+(2.031)+(3.004), (I-749)+(2.031)+(3.005), (I-749)+(2.031)+(3.006), (I-749)+(2.031)+(3.007), (I-749)+(2.031)+(3.008), (I-749)+(2.031)+(3.009), (I-749)+(2.031)+(3.010), (I-749)+(2.031)+(3.011), (I-749)+(2.031)+(3.012), (I-749)+(2.031)+(3.013), (I-749)+(2.031)+(3.014), (I-749)+(2.031)+(3.015), (I-749)+(2.031)+(3.016), (I-749)+(2.031)+(3.017), (I-749)+(2.031)+(3.018), (I-749)+(2.031)+(3.019), (I-749)+(2.031)+(3.020), (I-749)+(2.031)+(3.021), (I-749)+(2.031)+(3.022), (I-749)+(2.031)+(3.023), (I-749)+(2.031)+(3.024), (I-749)+(2.031)+(3.025), (I-749)+(2.031)+(3.026), (I-749)+(2.031)+(3.027), (I-749)+(2.031)+(3.028), (I-749)+(2.031)+(3.029), (I-749)+(2.031)+(3.030), (I-749)+(2.031)+(3.031), (I-749)+(2.031)+(5.001), (I-749)+(2.031)+(5.002), (I-749)+(2.031)+(5.003), (I-749)+(2.031)+(5.004), (I-749)+(2.031)+(5.005), (I-749)+(2.031)+(5.006), (I-749)+(2.031)+(5.007), (I-749)+(2.031)+(5.008), (I-749)+(2.031)+(5.009), (I-749)+(2.031)+(5.010), (I-749)+(2.031)+(5.011), (I-749)+(2.031)+(5.012), (I-749)+(2.031)+(5.013), (I-749)+(2.031)+(5.014), (I-749)+(2.031)+(5.015), (I-749)+(2.031)+(5.016), (I-749)+(2.031)+(5.017), (I-749)+(2.031)+(5.018), (I-749)+(2.031)+(5.019), (I-749)+(2.031)+(5.020), (I-749)+(2.031)+(5.021), (I-749)+(2.031)+(5.022), (I-749)+(2.031)+(5.023), (I-749)+(2.031)+(6.001), (I-749)+(2.031)+(6.002), (I-749)+(2.031)+(6.003), (I-749)+(2.031)+(6.004), (I-749)+(2.031)+(7.001), (I-749)+(2.031)+(7.002), (I-749)+(2.031)+(7.003), (I-749)+(2.031)+(7.004), (I-749)+(2.031)+(7.005), (I-749)+(2.031)+(7.006), (I-749)+(2.031)+(9.001), (I-749)+(2.031)+(9.002), (I-749)+(2.031)+(9.003), (I-749)+(2.031)+(9.004), (I-749)+(2.031)+(9.005), (I-749)+(2.031)+(9.006), (I-749)+(2.031)+(9.007), (I-749)+(2.031)+(9.008), (I-749)+(2.031)+(9.009), (I-749)+(2.031)+(14.001), (I-749)+(2.031)+(14.002), (I-749)+(2.031)+(15.008), (I-749)+(2.031)+(15.011), (I-749)+(2.031)+(15.012), (I-749)+(2.031)+(15.016), (I-749)+(2.031)+(15.025), (I-749)+(2.031)+(15.027), (I-749)+(2.031)+(15.047), (I-749)+(2.031)+(15.063), (I-749)+(2.031)+(15.064), (I-749)+(2.031)+(16.001), (I-749)+(2.031)+(16.002), (I-749)+(2.031)+(16.003), (I-749)+(2.031)+(16.004), (I-749)+(2.031)+(16.005), (I-749)+(2.031)+(16.006), (I-749)+(2.031)+(16.007), (I-749)+(2.031)+(16.008), (I-749)+(2.031)+(17.001), (I-749)+(2.031)+(17.002), (I-749)+(2.031)+(17.003), (I-749)+(2.031)+(17.004), (I-749)+(2.031)+(17.005), (I-749)+(2.031)+(17.006), (I-749)+(2.031)+(17.007), (I-749)+(2.031)+(17.008), (I-749)+(2.031)+(17.009), (I-749)+(2.031)+(17.010), (I-749)+(2.031)+(17.011), (I-749)+(2.031)+(17.012), (I-749)+(2.031)+(18.001),

(I-749)+(2.032)+(3.001), (I-749)+(2.032)+(3.002), (I-749)+(2.032)+(3.003), (I-749)+(2.032)+(3.004), (I-749)+(2.032)+(3.005), (I-749)+(2.032)+(3.006), (I-749)+(2.032)+(3.007), (I-749)+(2.032)+(3.008), (I-749)+(2.032)+(3.009), (I-749)+(2.032)+(3.010), (I-749)+(2.032)+(3.011), (I-749)+(2.032)+(3.012), (I-749)+(2.032)+(3.013), (I-749)+(2.032)+(3.014), (I-749)+(2.032)+(3.015), (I-749)+(2.032)+(3.016), (I-749)+(2.032)+(3.017), (I-749)+(2.032)+(3.018), (I-749)+(2.032)+(3.019), (I-749)+(2.032)+(3.020), (I-749)+(2.032)+(3.021), (I-749)+(2.032)+(3.022), (I-749)+(2.032)+(3.023), (I-749)+(2.032)+(3.024), (I-749)+(2.032)+(3.025), (I-749)+(2.032)+(3.026), (I-749)+(2.032)+(3.027), (I-749)+(2.032)+(3.028), (I-749)+(2.032)+(3.029), (I-749)+(2.032)+(3.030), (I-749)+(2.032)+(3.031), (I-749)+(2.032)+(5.001), (I-749)+(2.032)+(5.002), (I-749)+(2.032)+(5.003), (I-749)+(2.032)+(5.004), (I-749)+(2.032)+(5.005), (I-749)+(2.032)+(5.006), (I-749)+(2.032)+(5.007), (I-749)+(2.032)+(5.008), (I-749)+(2.032)+(5.009), (I-749)+(2.032)+(5.010), (I-749)+(2.032)+(5.011), (I-749)+(2.032)+(5.012), (I-749)+(2.032)+(5.013), (I-749)+(2.032)+(5.014), (I-749)+(2.032)+(5.015), (I-749)+(2.032)+(5.016), (I-749)+(2.032)+(5.017), (I-749)+(2.032)+(5.018), (I-749)+(2.032)+(5.019), (I-749)+(2.032)+(5.020), (I-749)+(2.032)+(5.021), (I-749)+(2.032)+(5.022), (I-749)+(2.032)+(5.023), (I-749)+(2.032)+(6.001), (I-749)+(2.032)+(6.002), (I-749)+(2.032)+(6.003), (I-749)+(2.032)+(6.004), (I-749)+(2.032)+(7.001), (I-749)+(2.032)+(7.002), (I-749)+(2.032)+(7.003), (I-749)+(2.032)+(7.004), (I-749)+(2.032)+(7.005), (I-749)+(2.032)+(7.006), (I-749)+(2.032)+(9.001), (I-749)+(2.032)+(9.002), (I-749)+(2.032)+(9.003), (I-749)+(2.032)+(9.004), (I-749)+(2.032)+(9.005), (I-749)+(2.032)+(9.006), (I-749)+(2.032)+(9.007), (I-749)+(2.032)+(9.008), (I-749)+(2.032)+(9.009), (I-749)+(2.032)+(14.001), (I-749)+(2.032)+(14.002), (I-749)+(2.032)+(15.008), (I-749)+(2.032)+(15.011), (I-749)+(2.032)+(15.012), (I-749)+(2.032)+(15.016), (I-749)+(2.032)+(15.025), (I-749)+(2.032)+(15.027), (I-749)+(2.032)+(15.047), (I-749)+(2.032)+(15.063), (I-749)+(2.032)+(15.064), (I-749)+(2.032)+(16.001), (I-749)+(2.032)+(16.002), (I-749)+(2.032)+(16.003), (I-749)+(2.032)+(16.004), (I-749)+(2.032)+(16.005), (I-749)+(2.032)+(16.006), (I-749)+(2.032)+(16.007), (I-749)+(2.032)+(16.008), (I-749)+(2.032)+(17.001), (I-749)+(2.032)+(17.002), (I-749)+(2.032)+(17.003), (I-749)+(2.032)+(17.004), (I-749)+(2.032)+(17.005), (I-749)+(2.032)+(17.006), (I-749)+(2.032)+(17.007), (I-749)+(2.032)+(17.008), (I-749)+(2.032)+(17.009), (I-749)+(2.032)+(17.010), (I-749)+(2.032)+(17.011), (I-749)+(2.032)+(17.012), (I-749)+(2.032)+(18.001),

(I-749)+(2.033)+(3.001), (I-749)+(2.033)+(3.002), (I-749)+(2.033)+(3.003), (I-749)+(2.033)+(3.004), (I-749)+(2.033)+(3.005), (I-749)+(2.033)+(3.006), (I-749)+(2.033)+(3.007), (I-749)+(2.033)+(3.008), (I-749)+(2.033)+(3.009), (I-749)+(2.033)+(3.010), (I-749)+(2.033)+(3.011), (I-749)+(2.033)+(3.012), (I-749)+(2.033)+(3.013), (I-749)+(2.033)+(3.014), (I-749)+(2.033)+(3.015), (I-749)+(2.033)+(3.016), (I-749)+(2.033)+(3.017), (I-749)+(2.033)+(3.018), (I-749)+(2.033)+(3.019), (I-749)+(2.033)+(3.020), (I-749)+(2.033)+(3.021), (I-749)+(2.033)+(3.022), (I-749)+(2.033)+(3.023), (I-749)+(2.033)+(3.024), (I-749)+(2.033)+(3.025), (I-749)+(2.033)+(3.026), (I-749)+(2.033)+(3.027), (I-749)+(2.033)+(3.028), (I-749)+(2.033)+(3.029), (I-749)+(2.033)+(3.030), (I-749)+(2.033)+(3.031), (I-749)+(2.033)+(5.001), (I-749)+(2.033)+(5.002), (I-749)+(2.033)+(5.003), (I-749)+(2.033)+(5.004), (I-749)+(2.033)+(5.005), (I-749)+(2.033)+(5.006), (I-749)+(2.033)+(5.007), (I-749)+(2.033)+(5.008), (I-749)+(2.033)+(5.009), (I-749)+(2.033)+(5.010), (I-749)+(2.033)+(5.011), (I-749)+(2.033)+(5.012), (I-749)+(2.033)+(5.013), (I-749)+(2.033)+(5.014), (I-749)+(2.033)+(5.015), (I-749)+(2.033)+(5.016), (I-749)+(2.033)+(5.017), (I-749)+(2.033)+(5.018), (I-749)+(2.033)+(5.019), (I-749)+(2.033)+(5.020), (I-749)+(2.033)+(5.021), (I-749)+(2.033)+(5.022), (I-749)+(2.033)+(5.023), (I-749)+(2.033)+(6.001), (I-749)+(2.033)+(6.002), (I-749)+(2.033)+(6.003), (I-749)+(2.033)+(6.004), (I-749)+(2.033)+(7.001), (I-749)+(2.033)+(7.002), (I-749)+(2.033)+(7.003), (I-749)+(2.033)+(7.004), (I-749)+(2.033)+(7.005), (I-749)+(2.033)+(7.006), (I-749)+(2.033)+(9.001), (I-749)+(2.033)+(9.002), (I-749)+(2.033)+(9.003), (I-749)+(2.033)+(9.004), (I-749)+(2.033)+(9.005), (I-749)+(2.033)+(9.006), (I-749)+(2.033)+(9.007), (I-749)+(2.033)+(9.008), (I-749)+(2.033)+(9.009), (I-749)+(2.033)+(14.001), (I-749)+(2.033)+(14.002), (I-749)+(2.033)+(15.008), (I-749)+(2.033)+(15.011), (I-749)+(2.033)+(15.012), (I-749)+(2.033)+(15.016), (I-749)+(2.033)+(15.025), (I-749)+(2.033)+(15.027), (I-749)+(2.033)+(15.047), (I-749)+(2.033)+(15.063), (I-749)+(2.033)+(15.064), (I-749)+(2.033)+(16.001), (I-749)+(2.033)+(16.002), (I-749)+(2.033)+(16.003), (I-749)+(2.033)+(16.004), (I-749)+(2.033)+(16.005), (I-749)+(2.033)+(16.006), (I-749)+(2.033)+(16.007), (I-749)+(2.033)+(16.008), (I-749)+(2.033)+(17.001), (I-749)+(2.033)+(17.002), (I-749)+(2.033)+(17.003), (I-749)+(2.033)+(17.004), (I-749)+(2.033)+(17.005), (I-749)+(2.033)+(17.006), (I-749)+(2.033)+(17.007), (I-749)+(2.033)+(17.008), (I-749)+(2.033)+(17.009), (I-749)+(2.033)+(17.010), (I-749)+(2.033)+(17.011), (I-749)+(2.033)+(17.012), (I-749)+(2.033)+(18.001),

(I-749)+(2.034)+(3.001), (I-749)+(2.034)+(3.002), (I-749)+(2.034)+(3.003), (I-749)+(2.034)+(3.004), (I-749)+(2.034)+(3.005), (I-749)+(2.034)+(3.006), (I-749)+(2.034)+(3.007), (I-749)+(2.034)+(3.008), (I-749)+(2.034)+(3.009), (I-749)+(2.034)+(3.010), (I-749)+(2.034)+(3.011), (I-749)+(2.034)+(3.012), (I-749)+(2.034)+(3.013), (I-749)+(2.034)+(3.014), (I-749)+(2.034)+(3.015), (I-749)+(2.034)+(3.016), (I-749)+(2.034)+(3.017), (I-749)+(2.034)+(3.018), (I-749)+(2.034)+(3.019), (I-749)+(2.034)+(3.020), (I-749)+(2.034)+(3.021), (I-749)+(2.034)+(3.022), (I-749)+(2.034)+(3.023), (I-749)+(2.034)+(3.024), (I-749)+(2.034)+(3.025), (I-749)+(2.034)+(3.026), (I-749)+(2.034)+(3.027), (I-749)+(2.034)+(3.028), (I-749)+(2.034)+(3.029), (I-749)+(2.034)+(3.030), (I-749)+(2.034)+(3.031), (I-749)+(2.034)+(5.001), (I-749)+(2.034)+(5.002), (I-749)+(2.034)+(5.003), (I-749)+(2.034)+(5.004), (I-749)+(2.034)+(5.005), (I-749)+(2.034)+(5.006), (I-749)+(2.034)+(5.007), (I-749)+(2.034)+(5.008), (I-749)+(2.034)+(5.009), (I-749)+(2.034)+(5.010), (I-749)+(2.034)+(5.011), (I-749)+(2.034)+(5.012), (I-749)+(2.034)+(5.013), (I-749)+(2.034)+(5.014), (I-749)+(2.034)+(5.015), (I-749)+(2.034)+(5.016), (I-749)+(2.034)+(5.017), (I-749)+(2.034)+(5.018), (I-749)+(2.034)+(5.019), (I-749)+(2.034)+(5.020), (I-749)+(2.034)+(5.021), (I-749)+(2.034)+(5.022), (I-749)+(2.034)+(5.023), (I-749)+(2.034)+(6.001), (I-749)+(2.034)+(6.002), (I-749)+(2.034)+(6.003), (I-749)+(2.034)+(6.004), (I-749)+(2.034)+(7.001), (I-749)+(2.034)+(7.002), (I-749)+(2.034)+(7.003), (I-749)+(2.034)+(7.004), (I-749)+(2.034)+(7.005), (I-749)+(2.034)+(7.006), (I-749)+(2.034)+(9.001), (I-749)+(2.034)+(9.002), (I-749)+(2.034)+(9.003), (I-749)+(2.034)+(9.004), (I-749)+(2.034)+(9.005), (I-749)+(2.034)+(9.006), (I-749)+(2.034)+(9.007), (I-749)+(2.034)+(9.008), (I-749)+(2.034)+(9.009), (I-749)+(2.034)+(14.001), (I-749)+(2.034)+(14.002), (I-749)+(2.034)+(15.008), (I-749)+(2.034)+(15.011), (I-749)+(2.034)+(15.012), (I-749)+(2.034)+(15.016), (I-749)+(2.034)+(15.025), (I-749)+(2.034)+(15.027), (I-749)+(2.034)+(15.047), (I-749)+(2.034)+(15.063), (I-749)+(2.034)+(15.064), (I-749)+(2.034)+(16.001), (I-749)+(2.034)+(16.002), (I-749)+(2.034)+(16.003), (I-749)+(2.034)+(16.004), (I-749)+(2.034)+(16.005), (I-749)+(2.034)+(16.006), (I-749)+(2.034)+(16.007), (I-749)+(2.034)+(16.008), (I-749)+(2.034)+(17.001), (I-749)+(2.034)+(17.002), (I-749)+(2.034)+(17.003), (I-749)+(2.034)+(17.004), (I-749)+(2.034)+(17.005), (I-749)+(2.034)+(17.006), (I-749)+(2.034)+(17.007), (I-749)+(2.034)+(17.008), (I-749)+(2.034)+(17.009), (I-749)+(2.034)+(17.010), (I-749)+(2.034)+(17.011), (I-749)+(2.034)+(17.012), (I-749)+(2.034)+(18.001),

(I-749)+(2.035)+(3.001), (I-749)+(2.035)+(3.002), (I-749)+(2.035)+(3.003), (I-749)+(2.035)+(3.004), (I-749)+(2.035)+(3.005), (I-749)+(2.035)+(3.006), (I-749)+(2.035)+(3.007), (I-749)+(2.035)+(3.008), (I-749)+(2.035)+(3.009), (I-749)+(2.035)+(3.010), (I-749)+(2.035)+(3.011), (I-749)+(2.035)+(3.012), (I-749)+(2.035)+(3.013), (I-749)+(2.035)+(3.014), (I-749)+(2.035)+(3.015), (I-749)+(2.035)+(3.016), (I-749)+(2.035)+(3.017), (I-749)+(2.035)+(3.018), (I-749)+(2.035)+(3.019), (I-749)+(2.035)+(3.020), (I-749)+(2.035)+(3.021), (I-749)+(2.035)+(3.022), (I-749)+(2.035)+(3.023), (I-749)+(2.035)+(3.024), (I-749)+(2.035)+(3.025), (I-749)+(2.035)+(3.026), (I-749)+(2.035)+(3.027), (I-749)+(2.035)+(3.028), (I-749)+(2.035)+(3.029), (I-749)+(2.035)+(3.030), (I-749)+(2.035)+(3.031), (I-749)+(2.035)+(5.001), (I-749)+(2.035)+(5.002), (I-749)+(2.035)+(5.003), (I-749)+(2.035)+(5.004), (I-749)+(2.035)+(5.005), (I-749)+(2.035)+(5.006), (I-749)+(2.035)+(5.007), (I-749)+(2.035)+(5.008), (I-749)+(2.035)+(5.009), (I-749)+(2.035)+(5.010), (I-749)+(2.035)+(5.011), (I-749)+(2.035)+(5.012), (I-749)+(2.035)+(5.013), (I-749)+(2.035)+(5.014), (I-749)+(2.035)+(5.015), (I-749)+(2.035)+(5.016), (I-749)+(2.035)+(5.017), (I-749)+(2.035)+(5.018), (I-749)+(2.035)+(5.019), (I-749)+(2.035)+(5.020), (I-749)+(2.035)+(5.021), (I-749)+(2.035)+(5.022), (I-749)+(2.035)+(5.023), (I-749)+(2.035)+(6.001), (I-749)+(2.035)+(6.002), (I-749)+(2.035)+(6.003), (I-749)+(2.035)+(6.004), (I-749)+(2.035)+(7.001), (I-749)+(2.035)+(7.002), (I-749)+(2.035)+(7.003), (I-749)+(2.035)+(7.004), (I-749)+(2.035)+(7.005), (I-749)+(2.035)+(7.006), (I-749)+(2.035)+(9.001), (I-749)+(2.035)+(9.002), (I-749)+(2.035)+(9.003), (I-749)+(2.035)+(9.004), (I-749)+(2.035)+(9.005), (I-749)+(2.035)+(9.006), (I-749)+(2.035)+(9.007), (I-749)+(2.035)+(9.008), (I-749)+(2.035)+(9.009), (I-749)+(2.035)+(14.001), (I-749)+(2.035)+(14.002), (I-749)+(2.035)+(15.008), (I-749)+(2.035)+(15.011), (I-749)+(2.035)+(15.012), (I-749)+(2.035)+(15.016), (I-749)+(2.035)+(15.025), (I-749)+(2.035)+(15.027), (I-749)+(2.035)+(15.047), (I-749)+(2.035)+(15.063), (I-749)+(2.035)+(15.064), (I-749)+(2.035)+(16.001), (I-749)+(2.035)+(16.002), (I-749)+(2.035)+(16.003), (I-749)+(2.035)+(16.004), (I-749)+(2.035)+(16.005), (I-749)+(2.035)+(16.006), (I-749)+(2.035)+(16.007), (I-749)+(2.035)+(16.008), (I-749)+(2.035)+(17.001), (I-749)+(2.035)+(17.002), (I-749)+(2.035)+(17.003), (I-749)+(2.035)+(17.004), (I-749)+(2.035)+(17.005), (I-749)+(2.035)+(17.006), (I-749)+(2.035)+(17.007), (I-749)+(2.035)+(17.008), (I-749)+(2.035)+(17.009), (I-749)+(2.035)+(17.010), (I-749)+(2.035)+(17.011), (I-749)+(2.035)+(17.012), (I-749)+(2.035)+(18.001),

(I-749)+(2.036)+(3.001), (I-749)+(2.036)+(3.002), (I-749)+(2.036)+(3.003), (I-749)+(2.036)+(3.004), (I-749)+(2.036)+(3.005), (I-749)+(2.036)+(3.006), (I-749)+(2.036)+(3.007), (I-749)+(2.036)+(3.008), (I-749)+(2.036)+(3.009), (I-749)+(2.036)+(3.010), (I-749)+(2.036)+(3.011), (I-749)+(2.036)+(3.012), (I-749)+(2.036)+(3.013), (I-749)+(2.036)+(3.014), (I-749)+(2.036)+(3.015), (I-749)+(2.036)+(3.016), (I-749)+(2.036)+(3.017), (I-749)+(2.036)+(3.018), (I-749)+(2.036)+(3.019), (I-749)+(2.036)+(3.020), (I-749)+(2.036)+(3.021), (I-749)+(2.036)+(3.022), (I-749)+(2.036)+(3.023), (I-749)+(2.036)+(3.024), (I-749)+(2.036)+(3.025), (I-749)+(2.036)+(3.026), (I-749)+(2.036)+(3.027), (I-749)+(2.036)+(3.028), (I-749)+(2.036)+(3.029), (I-749)+(2.036)+(3.030), (I-749)+(2.036)+(3.031), (I-749)+(2.036)+(5.001), (I-749)+(2.036)+(5.002), (I-749)+(2.036)+(5.003), (I-749)+(2.036)+(5.004), (I-749)+(2.036)+(5.005), (I-749)+(2.036)+(5.006), (I-749)+(2.036)+(5.007), (I-749)+(2.036)+(5.008), (I-749)+(2.036)+(5.009), (I-749)+(2.036)+(5.010), (I-749)+(2.036)+(5.011), (I-749)+(2.036)+(5.012), (I-749)+(2.036)+(5.013), (I-749)+(2.036)+(5.014), (I-749)+(2.036)+(5.015), (I-749)+(2.036)+(5.016), (I-749)+(2.036)+(5.017), (I-749)+(2.036)+(5.018), (I-749)+(2.036)+(5.019), (I-749)+(2.036)+(5.020), (I-749)+(2.036)+(5.021), (I-749)+(2.036)+(5.022), (I-749)+(2.036)+(5.023), (I-749)+(2.036)+(6.001), (I-749)+(2.036)+(6.002), (I-749)+(2.036)+(6.003), (I-749)+(2.036)+(6.004), (I-749)+(2.036)+(7.001), (I-749)+(2.036)+(7.002), (I-749)+(2.036)+(7.003), (I-749)+(2.036)+(7.004), (I-749)+(2.036)+(7.005), (I-749)+(2.036)+(7.006), (I-749)+(2.036)+(9.001), (I-749)+(2.036)+(9.002), (I-749)+(2.036)+(9.003), (I-749)+(2.036)+(9.004), (I-749)+(2.036)+(9.005), (I-749)+(2.036)+(9.006), (I-749)+(2.036)+(9.007), (I-749)+(2.036)+(9.008), (I-749)+(2.036)+(9.009), (I-749)+(2.036)+(14.001), (I-749)+(2.036)+(14.002), (I-749)+(2.036)+(15.008), (I-749)+(2.036)+(15.011), (I-749)+(2.036)+(15.012), (I-749)+(2.036)+(15.016), (I-749)+(2.036)+(15.025), (I-749)+(2.036)+(15.027), (I-749)+(2.036)+(15.047), (I-749)+(2.036)+(15.063), (I-749)+(2.036)+(15.064), (I-749)+(2.036)+(16.001), (I-749)+(2.036)+(16.002), (I-749)+(2.036)+(16.003), (I-749)+(2.036)+(16.004), (I-749)+(2.036)+(16.005), (I-749)+(2.036)+(16.006), (I-749)+(2.036)+(16.007), (I-749)+(2.036)+(16.008), (I-749)+(2.036)+(17.001), (I-749)+(2.036)+(17.002), (I-749)+(2.036)+(17.003), (I-749)+(2.036)+(17.004), (I-749)+(2.036)+(17.005), (I-749)+(2.036)+(17.006), (I-749)+(2.036)+(17.007), (I-749)+(2.036)+(17.008), (I-749)+(2.036)+(17.009), (I-749)+(2.036)+(17.010), (I-749)+(2.036)+(17.011), (I-749)+(2.036)+(17.012), (I-749)+(2.036)+(18.001),

(I-749)+(2.037)+(3.001), (I-749)+(2.037)+(3.002), (I-749)+(2.037)+(3.003), (I-749)+(2.037)+(3.004), (I-749)+(2.037)+(3.005), (I-749)+(2.037)+(3.006), (I-749)+(2.037)+(3.007), (I-749)+(2.037)+(3.008), (I-749)+(2.037)+(3.009), (I-749)+(2.037)+(3.010), (I-749)+(2.037)+(3.011), (I-749)+(2.037)+(3.012), (I-749)+(2.037)+(3.013), (I-749)+(2.037)+(3.014), (I-749)+(2.037)+(3.015), (I-749)+(2.037)+(3.016), (I-749)+(2.037)+(3.017), (I-749)+(2.037)+(3.018), (I-749)+(2.037)+(3.019), (I-749)+(2.037)+(3.020), (I-749)+(2.037)+(3.021), (I-749)+(2.037)+(3.022), (I-749)+(2.037)+(3.023), (I-749)+(2.037)+(3.024), (I-749)+(2.037)+(3.025), (I-749)+(2.037)+(3.026), (I-749)+(2.037)+(3.027), (I-749)+(2.037)+(3.028), (I-749)+(2.037)+(3.029), (I-749)+(2.037)+(3.030), (I-749)+(2.037)+(3.031), (I-749)+(2.037)+(5.001), (I-749)+(2.037)+(5.002), (I-749)+(2.037)+(5.003), (I-749)+(2.037)+(5.004), (I-749)+(2.037)+(5.005), (I-749)+(2.037)+(5.006), (I-749)+(2.037)+(5.007), (I-749)+(2.037)+(5.008), (I-749)+(2.037)+(5.009), (I-749)+(2.037)+(5.010), (I-749)+(2.037)+(5.011), (I-749)+(2.037)+(5.012), (I-749)+(2.037)+(5.013), (I-749)+(2.037)+(5.014), (I-749)+(2.037)+(5.015), (I-749)+(2.037)+(5.016), (I-749)+(2.037)+(5.017), (I-749)+(2.037)+(5.018), (I-749)+(2.037)+(5.019), (I-749)+(2.037)+(5.020), (I-749)+(2.037)+(5.021), (I-749)+(2.037)+(5.022), (I-749)+(2.037)+(5.023), (I-749)+(2.037)+(6.001), (I-749)+(2.037)+(6.002), (I-749)+(2.037)+(6.003), (I-749)+(2.037)+(6.004), (I-749)+(2.037)+(7.001), (I-749)+(2.037)+(7.002), (I-749)+(2.037)+(7.003), (I-749)+(2.037)+(7.004), (I-749)+(2.037)+(7.005), (I-749)+(2.037)+(7.006), (I-749)+(2.037)+(9.001), (I-749)+(2.037)+(9.002), (I-749)+(2.037)+(9.003), (I-749)+(2.037)+(9.004), (I-749)+(2.037)+(9.005), (I-749)+(2.037)+(9.006), (I-749)+(2.037)+(9.007), (I-749)+(2.037)+(9.008), (I-749)+(2.037)+(9.009), (I-749)+(2.037)+(14.001), (I-749)+(2.037)+(14.002), (I-749)+(2.037)+(15.008), (I-749)+(2.037)+(15.011), (I-749)+(2.037)+(15.012), (I-749)+(2.037)+(15.016), (I-749)+(2.037)+(15.025), (I-749)+(2.037)+(15.027), (I-749)+(2.037)+(15.047), (I-749)+(2.037)+(15.063), (I-749)+(2.037)+(15.064), (I-749)+(2.037)+(16.001), (I-749)+(2.037)+(16.002), (I-749)+(2.037)+(16.003), (I-749)+(2.037)+(16.004), (I-749)+(2.037)+(16.005), (I-749)+(2.037)+(16.006), (I-749)+(2.037)+(16.007), (I-749)+(2.037)+(16.008), (I-749)+(2.037)+(17.001), (I-749)+(2.037)+(17.002), (I-749)+(2.037)+(17.003), (I-749)+(2.037)+(17.004), (I-749)+(2.037)+(17.005), (I-749)+(2.037)+(17.006), (I-749)+(2.037)+(17.007), (I-749)+(2.037)+(17.008), (I-749)+(2.037)+(17.009), (I-749)+(2.037)+(17.010), (I-749)+(2.037)+(17.011), (I-749)+(2.037)+(17.012), (I-749)+(2.037)+(18.001),

(I-749)+(2.038)+(3.001), (I-749)+(2.038)+(3.002), (I-749)+(2.038)+(3.003), (I-749)+(2.038)+(3.004), (I-749)+(2.038)+(3.005), (I-749)+(2.038)+(3.006), (I-749)+(2.038)+(3.007), (I-749)+(2.038)+(3.008), (I-749)+(2.038)+(3.009), (I-749)+(2.038)+(3.010), (I-749)+(2.038)+(3.011), (I-749)+(2.038)+(3.012), (I-749)+(2.038)+(3.013), (I-749)+(2.038)+(3.014), (I-749)+(2.038)+(3.015), (I-749)+(2.038)+(3.016), (I-749)+(2.038)+(3.017), (I-749)+(2.038)+(3.018), (I-749)+(2.038)+(3.019), (I-749)+(2.038)+(3.020), (I-749)+(2.038)+(3.021), (I-749)+(2.038)+(3.022), (I-749)+(2.038)+(3.023), (I-749)+(2.038)+(3.024), (I-749)+(2.038)+(3.025), (I-749)+(2.038)+(3.026), (I-749)+(2.038)+(3.027), (I-749)+(2.038)+(3.028), (I-749)+(2.038)+(3.029), (I-749)+(2.038)+(3.030), (I-749)+(2.038)+(3.031), (I-749)+(2.038)+(5.001), (I-749)+(2.038)+(5.002), (I-749)+(2.038)+(5.003), (I-749)+(2.038)+(5.004), (I-749)+(2.038)+(5.005), (I-749)+(2.038)+(5.006), (I-749)+(2.038)+(5.007), (I-749)+(2.038)+(5.008), (I-749)+(2.038)+(5.009), (I-749)+(2.038)+(5.010), (I-749)+(2.038)+(5.011), (I-749)+(2.038)+(5.012), (I-749)+(2.038)+(5.013), (I-749)+(2.038)+(5.014), (I-749)+(2.038)+(5.015), (I-749)+(2.038)+(5.016), (I-749)+(2.038)+(5.017), (I-749)+(2.038)+(5.018), (I-749)+(2.038)+(5.019), (I-749)+(2.038)+(5.020), (I-749)+(2.038)+(5.021), (I-749)+(2.038)+(5.022), (I-749)+(2.038)+(5.023), (I-749)+(2.038)+(6.001), (I-749)+(2.038)+(6.002), (I-749)+(2.038)+(6.003), (I-749)+(2.038)+(6.004), (I-749)+(2.038)+(7.001), (I-749)+(2.038)+(7.002), (I-749)+(2.038)+(7.003), (I-749)+(2.038)+(7.004), (I-749)+(2.038)+(7.005), (I-749)+(2.038)+(7.006), (I-749)+(2.038)+(9.001), (I-749)+(2.038)+(9.002), (I-749)+(2.038)+(9.003), (I-749)+(2.038)+(9.004), (I-749)+(2.038)+(9.005), (I-749)+(2.038)+(9.006), (I-749)+(2.038)+(9.007), (I-749)+(2.038)+(9.008), (I-749)+(2.038)+(9.009), (I-749)+(2.038)+(14.001), (I-749)+(2.038)+(14.002), (I-749)+(2.038)+(15.008), (I-749)+(2.038)+(15.011), (I-749)+(2.038)+(15.012), (I-749)+(2.038)+(15.016), (I-749)+(2.038)+(15.025), (I-749)+(2.038)+(15.027), (I-749)+(2.038)+(15.047), (I-749)+(2.038)+(15.063), (I-749)+(2.038)+(15.064), (I-749)+(2.038)+(16.001), (I-749)+(2.038)+(16.002), (I-749)+(2.038)+(16.003), (I-749)+(2.038)+(16.004), (I-749)+(2.038)+(16.005), (I-749)+(2.038)+(16.006), (I-749)+(2.038)+(16.007), (I-749)+(2.038)+(16.008), (I-749)+(2.038)+(17.001), (I-749)+(2.038)+(17.002), (I-749)+(2.038)+(17.003), (I-749)+(2.038)+(17.004), (I-749)+(2.038)+(17.005), (I-749)+(2.038)+(17.006), (I-749)+(2.038)+(17.007), (I-749)+(2.038)+(17.008), (I-749)+(2.038)+(17.009), (I-749)+(2.038)+(17.010), (I-749)+(2.038)+(17.011), (I-749)+(2.038)+(17.012), (I-749)+(2.038)+(18.001),

(I-749)+(2.039)+(3.001), (I-749)+(2.039)+(3.002), (I-749)+(2.039)+(3.003), (I-749)+(2.039)+(3.004), (I-749)+(2.039)+(3.005), (I-749)+(2.039)+(3.006), (I-749)+(2.039)+(3.007), (I-749)+(2.039)+(3.008), (I-749)+(2.039)+(3.009), (I-749)+(2.039)+(3.010), (I-749)+(2.039)+(3.011), (I-749)+(2.039)+(3.012), (I-749)+(2.039)+(3.013), (I-749)+(2.039)+(3.014), (I-749)+(2.039)+(3.015), (I-749)+(2.039)+(3.016), (I-749)+(2.039)+(3.017), (I-749)+(2.039)+(3.018), (I-749)+(2.039)+(3.019), (I-749)+(2.039)+(3.020), (I-749)+(2.039)+(3.021), (I-749)+(2.039)+(3.022), (I-749)+(2.039)+(3.023), (I-749)+(2.039)+(3.024), (I-749)+(2.039)+(3.025), (I-749)+(2.039)+(3.026), (I-749)+(2.039)+(3.027), (I-749)+(2.039)+(3.028), (I-749)+(2.039)+(3.029), (I-749)+(2.039)+(3.030), (I-749)+(2.039)+(3.031), (I-749)+(2.039)+(5.001), (I-749)+(2.039)+(5.002), (I-749)+(2.039)+(5.003), (I-749)+(2.039)+(5.004), (I-749)+(2.039)+(5.005), (I-749)+(2.039)+(5.006), (I-749)+(2.039)+(5.007), (I-749)+(2.039)+(5.008), (I-749)+(2.039)+(5.009), (I-749)+(2.039)+(5.010), (I-749)+(2.039)+(5.011), (I-749)+(2.039)+(5.012), (I-749)+(2.039)+(5.013), (I-749)+(2.039)+(5.014), (I-749)+(2.039)+(5.015), (I-749)+(2.039)+(5.016), (I-749)+(2.039)+(5.017), (I-749)+(2.039)+(5.018), (I-749)+(2.039)+(5.019), (I-749)+(2.039)+(5.020), (I-749)+(2.039)+(5.021), (I-749)+(2.039)+(5.022), (I-749)+(2.039)+(5.023), (I-749)+(2.039)+(6.001), (I-749)+(2.039)+(6.002), (I-749)+(2.039)+(6.003), (I-749)+(2.039)+(6.004), (I-749)+(2.039)+(7.001), (I-749)+(2.039)+(7.002), (I-749)+(2.039)+(7.003), (I-749)+(2.039)+(7.004), (I-749)+(2.039)+(7.005), (I-749)+(2.039)+(7.006), (I-749)+(2.039)+(9.001), (I-749)+(2.039)+(9.002), (I-749)+(2.039)+(9.003), (I-749)+(2.039)+(9.004), (I-749)+(2.039)+(9.005), (I-749)+(2.039)+(9.006), (I-749)+(2.039)+(9.007), (I-749)+(2.039)+(9.008), (I-749)+(2.039)+(9.009), (I-749)+(2.039)+(14.001), (I-749)+(2.039)+(14.002), (I-749)+(2.039)+(15.008), (I-749)+(2.039)+(15.011), (I-749)+(2.039)+(15.012), (I-749)+(2.039)+(15.016), (I-749)+(2.039)+(15.025), (I-749)+(2.039)+(15.027), (I-749)+(2.039)+(15.047), (I-749)+(2.039)+(15.063), (I-749)+(2.039)+(15.064), (I-749)+(2.039)+(16.001), (I-749)+(2.039)+(16.002), (I-749)+(2.039)+(16.003), (I-749)+(2.039)+(16.004), (I-749)+(2.039)+(16.005), (I-749)+(2.039)+(16.006), (I-749)+(2.039)+(16.007), (I-749)+(2.039)+(16.008), (I-749)+(2.039)+(17.001), (I-749)+(2.039)+(17.002), (I-749)+(2.039)+(17.003), (I-749)+(2.039)+(17.004), (I-749)+(2.039)+(17.005), (I-749)+(2.039)+(17.006), (I-749)+(2.039)+(17.007), (I-749)+(2.039)+(17.008), (I-749)+(2.039)+(17.009), (I-749)+(2.039)+(17.010), (I-749)+(2.039)+(17.011), (I-749)+(2.039)+(17.012), (I-749)+(2.039)+(18.001),

(I-749)+(2.040)+(3.001), (I-749)+(2.040)+(3.002), (I-749)+(2.040)+(3.003), (I-749)+(2.040)+(3.004), (I-749)+(2.040)+(3.005), (I-749)+(2.040)+(3.006), (I-749)+(2.040)+(3.007), (I-749)+(2.040)+(3.008), (I-749)+(2.040)+(3.009), (I-749)+(2.040)+(3.010), (I-749)+(2.040)+(3.011), (I-749)+(2.040)+(3.012), (I-749)+(2.040)+(3.013), (I-749)+(2.040)+(3.014), (I-749)+(2.040)+(3.015), (I-749)+(2.040)+(3.016), (I-749)+(2.040)+(3.017), (I-749)+(2.040)+(3.018), (I-749)+(2.040)+(3.019), (I-749)+(2.040)+(3.020), (I-749)+(2.040)+(3.021), (I-749)+(2.040)+(3.022), (I-749)+(2.040)+(3.023), (I-749)+(2.040)+(3.024), (I-749)+(2.040)+(3.025), (I-749)+(2.040)+(3.026), (I-749)+(2.040)+(3.027), (I-749)+(2.040)+(3.028), (I-749)+(2.040)+(3.029), (I-749)+(2.040)+(3.030), (I-749)+(2.040)+(3.031), (I-749)+(2.040)+(5.001), (I-749)+(2.040)+(5.002), (I-749)+(2.040)+(5.003), (I-749)+(2.040)+(5.004), (I-749)+(2.040)+(5.005), (I-749)+(2.040)+(5.006), (I-749)+(2.040)+(5.007), (I-749)+(2.040)+(5.008), (I-749)+(2.040)+(5.009), (I-749)+(2.040)+(5.010), (I-749)+(2.040)+(5.011), (I-749)+(2.040)+(5.012), (I-749)+(2.040)+(5.013), (I-749)+(2.040)+(5.014), (I-749)+(2.040)+(5.015), (I-749)+(2.040)+(5.016), (I-749)+(2.040)+(5.017), (I-749)+(2.040)+(5.018), (I-749)+(2.040)+(5.019), (I-749)+(2.040)+(5.020), (I-749)+(2.040)+(5.021), (I-749)+(2.040)+(5.022), (I-749)+(2.040)+(5.023), (I-749)+(2.040)+(6.001), (I-749)+(2.040)+(6.002), (I-749)+(2.040)+(6.003), (I-749)+(2.040)+(6.004), (I-749)+(2.040)+(7.001), (I-749)+(2.040)+(7.002), (I-749)+(2.040)+(7.003), (I-749)+(2.040)+(7.004), (I-749)+(2.040)+(7.005), (I-749)+(2.040)+(7.006), (I-749)+(2.040)+(9.001), (I-749)+(2.040)+(9.002), (I-749)+(2.040)+(9.003), (I-749)+(2.040)+(9.004), (I-749)+(2.040)+(9.005), (I-749)+(2.040)+(9.006), (I-749)+(2.040)+(9.007), (I-749)+(2.040)+(9.008), (I-749)+(2.040)+(9.009), (I-749)+(2.040)+(14.001), (I-749)+(2.040)+(14.002), (I-749)+(2.040)+(15.008), (I-749)+(2.040)+(15.011), (I-749)+(2.040)+(15.012), (I-749)+(2.040)+(15.016), (I-749)+(2.040)+(15.025), (I-749)+(2.040)+(15.027), (I-749)+(2.040)+(15.047), (I-749)+(2.040)+(15.063), (I-749)+(2.040)+(15.064), (I-749)+(2.040)+(16.001), (I-749)+(2.040)+(16.002), (I-749)+(2.040)+(16.003), (I-749)+(2.040)+(16.004), (I-749)+(2.040)+(16.005), (I-749)+(2.040)+(16.006), (I-749)+(2.040)+(16.007), (I-749)+(2.040)+(16.008), (I-749)+(2.040)+(17.001), (I-749)+(2.040)+(17.002), (I-749)+(2.040)+(17.003), (I-749)+(2.040)+(17.004), (I-749)+(2.040)+(17.005), (I-749)+(2.040)+(17.006), (I-749)+(2.040)+(17.007), (I-749)+(2.040)+(17.008), (I-749)+(2.040)+(17.009), (I-749)+(2.040)+(17.010), (I-749)+(2.040)+(17.011), (I-749)+(2.040)+(17.012), (I-749)+(2.040)+(18.001),

(I-749)+(2.041)+(3.001), (I-749)+(2.041)+(3.002), (I-749)+(2.041)+(3.003), (I-749)+(2.041)+(3.004), (I-749)+(2.041)+(3.005), (I-749)+(2.041)+(3.006), (I-749)+(2.041)+(3.007), (I-749)+(2.041)+(3.008), (I-749)+(2.041)+(3.009), (I-749)+(2.041)+(3.010), (I-749)+(2.041)+(3.011), (I-749)+(2.041)+(3.012), (I-749)+(2.041)+(3.013), (I-749)+(2.041)+(3.014), (I-749)+(2.041)+(3.015), (I-749)+(2.041)+(3.016), (I-749)+(2.041)+(3.017), (I-749)+(2.041)+(3.018), (I-749)+(2.041)+(3.019), (I-749)+(2.041)+(3.020), (I-749)+(2.041)+(3.021), (I-749)+(2.041)+(3.022), (I-749)+(2.041)+(3.023), (I-749)+(2.041)+(3.024), (I-749)+(2.041)+(3.025), (I-749)+(2.041)+(3.026), (I-749)+(2.041)+(3.027), (I-749)+(2.041)+(3.028), (I-749)+(2.041)+(3.029), (I-749)+(2.041)+(3.030), (I-749)+(2.041)+(3.031), (I-749)+(2.041)+(5.001), (I-749)+(2.041)+(5.002), (I-749)+(2.041)+(5.003), (I-749)+(2.041)+(5.004), (I-749)+(2.041)+(5.005), (I-749)+(2.041)+(5.006), (I-749)+(2.041)+(5.007), (I-749)+(2.041)+(5.008), (I-749)+(2.041)+(5.009), (I-749)+(2.041)+(5.010), (I-749)+(2.041)+(5.011), (I-749)+(2.041)+(5.012), (I-749)+(2.041)+(5.013), (I-749)+(2.041)+(5.014), (I-749)+(2.041)+(5.015), (I-749)+(2.041)+(5.016), (I-749)+(2.041)+(5.017), (I-749)+(2.041)+(5.018), (I-749)+(2.041)+(5.019), (I-749)+(2.041)+(5.020), (I-749)+(2.041)+(5.021), (I-749)+(2.041)+(5.022), (I-749)+(2.041)+(5.023), (I-749)+(2.041)+(6.001), (I-749)+(2.041)+(6.002), (I-749)+(2.041)+(6.003), (I-749)+(2.041)+(6.004), (I-749)+(2.041)+(7.001), (I-749)+(2.041)+(7.002), (I-749)+(2.041)+(7.003), (I-749)+(2.041)+(7.004), (I-749)+(2.041)+(7.005), (I-749)+(2.041)+(7.006), (I-749)+(2.041)+(9.001), (I-749)+(2.041)+(9.002), (I-749)+(2.041)+(9.003), (I-749)+(2.041)+(9.004), (I-749)+(2.041)+(9.005), (I-749)+(2.041)+(9.006), (I-749)+(2.041)+(9.007), (I-749)+(2.041)+(9.008), (I-749)+(2.041)+(9.009), (I-749)+(2.041)+(14.001), (I-749)+(2.041)+(14.002), (I-749)+(2.041)+(15.008), (I-749)+(2.041)+(15.011), (I-749)+(2.041)+(15.012), (I-749)+(2.041)+(15.016), (I-749)+(2.041)+(15.025), (I-749)+(2.041)+(15.027), (I-749)+(2.041)+(15.047), (I-749)+(2.041)+(15.063), (I-749)+(2.041)+(15.064), (I-749)+(2.041)+(16.001), (I-749)+(2.041)+(16.002), (I-749)+(2.041)+(16.003), (I-749)+(2.041)+(16.004), (I-749)+(2.041)+(16.005), (I-749)+(2.041)+(16.006), (I-749)+(2.041)+(16.007), (I-749)+(2.041)+(16.008), (I-749)+(2.041)+(17.001), (I-749)+(2.041)+(17.002), (I-749)+(2.041)+(17.003), (I-749)+(2.041)+(17.004), (I-749)+(2.041)+(17.005), (I-749)+(2.041)+(17.006), (I-749)+(2.041)+(17.007), (I-749)+(2.041)+(17.008), (I-749)+(2.041)+(17.009), (I-749)+(2.041)+(17.010), (I-749)+(2.041)+(17.011), (I-749)+(2.041)+(17.012), (I-749)+(2.041)+(18.001),

(I-749)+(2.042)+(3.001), (I-749)+(2.042)+(3.002), (I-749)+(2.042)+(3.003), (I-749)+(2.042)+(3.004), (I-749)+(2.042)+(3.005), (I-749)+(2.042)+(3.006), (I-749)+(2.042)+(3.007), (I-749)+(2.042)+(3.008), (I-749)+(2.042)+(3.009), (I-749)+(2.042)+(3.010), (I-749)+(2.042)+(3.011), (I-749)+(2.042)+(3.012), (I-749)+(2.042)+(3.013), (I-749)+(2.042)+(3.014), (I-749)+(2.042)+(3.015), (I-749)+(2.042)+(3.016), (I-749)+(2.042)+(3.017), (I-749)+(2.042)+(3.018), (I-749)+(2.042)+(3.019), (I-749)+(2.042)+(3.020), (I-749)+(2.042)+(3.021), (I-749)+(2.042)+(3.022), (I-749)+(2.042)+(3.023), (I-749)+(2.042)+(3.024), (I-749)+(2.042)+(3.025), (I-749)+(2.042)+(3.026), (I-749)+(2.042)+(3.027), (I-749)+(2.042)+(3.028), (I-749)+(2.042)+(3.029), (I-749)+(2.042)+(3.030), (I-749)+(2.042)+(3.031), (I-749)+(2.042)+(5.001), (I-749)+(2.042)+(5.002), (I-749)+(2.042)+(5.003), (I-749)+(2.042)+(5.004), (I-749)+(2.042)+(5.005), (I-749)+(2.042)+(5.006), (I-749)+(2.042)+(5.007), (I-749)+(2.042)+(5.008), (I-749)+(2.042)+(5.009), (I-749)+(2.042)+(5.010), (I-749)+(2.042)+(5.011), (I-749)+(2.042)+(5.012), (I-749)+(2.042)+(5.013), (I-749)+(2.042)+(5.014), (I-749)+(2.042)+(5.015), (I-749)+(2.042)+(5.016), (I-749)+(2.042)+(5.017), (I-749)+(2.042)+(5.018), (I-749)+(2.042)+(5.019), (I-749)+(2.042)+(5.020), (I-749)+(2.042)+(5.021), (I-749)+(2.042)+(5.022), (I-749)+(2.042)+(5.023), (I-749)+(2.042)+(6.001), (I-749)+(2.042)+(6.002), (I-749)+(2.042)+(6.003), (I-749)+(2.042)+(6.004), (I-749)+(2.042)+(7.001), (I-749)+(2.042)+(7.002), (I-749)+(2.042)+(7.003), (I-749)+(2.042)+(7.004), (I-749)+(2.042)+(7.005), (I-749)+(2.042)+(7.006), (I-749)+(2.042)+(9.001), (I-749)+(2.042)+(9.002), (I-749)+(2.042)+(9.003), (I-749)+(2.042)+(9.004), (I-749)+(2.042)+(9.005), (I-749)+(2.042)+(9.006), (I-749)+(2.042)+(9.007), (I-749)+(2.042)+(9.008), (I-749)+(2.042)+(9.009), (I-749)+(2.042)+(14.001), (I-749)+(2.042)+(14.002), (I-749)+(2.042)+(15.008), (I-749)+(2.042)+(15.011), (I-749)+(2.042)+(15.012), (I-749)+(2.042)+(15.016), (I-749)+(2.042)+(15.025), (I-749)+(2.042)+(15.027), (I-749)+(2.042)+(15.047), (I-749)+(2.042)+(15.063), (I-749)+(2.042)+(15.064), (I-749)+(2.042)+(16.001), (I-749)+(2.042)+(16.002), (I-749)+(2.042)+(16.003), (I-749)+(2.042)+(16.004), (I-749)+(2.042)+(16.005), (I-749)+(2.042)+(16.006), (I-749)+(2.042)+(16.007), (I-749)+(2.042)+(16.008), (I-749)+(2.042)+(17.001), (I-749)+(2.042)+(17.002), (I-749)+(2.042)+(17.003), (I-749)+(2.042)+(17.004), (I-749)+(2.042)+(17.005), (I-749)+(2.042)+(17.006), (I-749)+(2.042)+(17.007), (I-749)+(2.042)+(17.008), (I-749)+(2.042)+(17.009), (I-749)+(2.042)+(17.010), (I-749)+(2.042)+(17.011), (I-749)+(2.042)+(17.012), (I-749)+(2.042)+(18.001),

(I-749)+(2.043)+(3.001), (I-749)+(2.043)+(3.002), (I-749)+(2.043)+(3.003), (I-749)+(2.043)+(3.004), (I-749)+(2.043)+(3.005), (I-749)+(2.043)+(3.006), (I-749)+(2.043)+(3.007), (I-749)+(2.043)+(3.008), (I-749)+(2.043)+(3.009), (I-749)+(2.043)+(3.010), (I-749)+(2.043)+(3.011), (I-749)+(2.043)+(3.012), (I-749)+(2.043)+(3.013), (I-749)+(2.043)+(3.014), (I-749)+(2.043)+(3.015), (I-749)+(2.043)+(3.016), (I-749)+(2.043)+(3.017), (I-749)+(2.043)+(3.018), (I-749)+(2.043)+(3.019), (I-749)+(2.043)+(3.020), (I-749)+(2.043)+(3.021), (I-749)+(2.043)+(3.022), (I-749)+(2.043)+(3.023), (I-749)+(2.043)+(3.024), (I-749)+(2.043)+(3.025), (I-749)+(2.043)+(3.026), (I-749)+(2.043)+(3.027), (I-749)+(2.043)+(3.028), (I-749)+(2.043)+(3.029), (I-749)+(2.043)+(3.030), (I-749)+(2.043)+(3.031), (I-749)+(2.043)+(5.001), (I-749)+(2.043)+(5.002), (I-749)+(2.043)+(5.003), (I-749)+(2.043)+(5.004), (I-749)+(2.043)+(5.005), (I-749)+(2.043)+(5.006), (I-749)+(2.043)+(5.007), (I-749)+(2.043)+(5.008), (I-749)+(2.043)+(5.009), (I-749)+(2.043)+(5.010), (I-749)+(2.043)+(5.011), (I-749)+(2.043)+(5.012), (I-749)+(2.043)+(5.013), (I-749)+(2.043)+(5.014), (I-749)+(2.043)+(5.015), (I-749)+(2.043)+(5.016), (I-749)+(2.043)+(5.017), (I-749)+(2.043)+(5.018), (I-749)+(2.043)+(5.019), (I-749)+(2.043)+(5.020), (I-749)+(2.043)+(5.021), (I-749)+(2.043)+(5.022), (I-749)+(2.043)+(5.023), (I-749)+(2.043)+(6.001), (I-749)+(2.043)+(6.002), (I-749)+(2.043)+(6.003), (I-749)+(2.043)+(6.004), (I-749)+(2.043)+(7.001), (I-749)+(2.043)+(7.002), (I-749)+(2.043)+(7.003), (I-749)+(2.043)+(7.004), (I-749)+(2.043)+(7.005), (I-749)+(2.043)+(7.006), (I-749)+(2.043)+(9.001), (I-749)+(2.043)+(9.002), (I-749)+(2.043)+(9.003), (I-749)+(2.043)+(9.004), (I-749)+(2.043)+(9.005), (I-749)+(2.043)+(9.006), (I-749)+(2.043)+(9.007), (I-749)+(2.043)+(9.008), (I-749)+(2.043)+(9.009), (I-749)+(2.043)+(14.001), (I-749)+(2.043)+(14.002), (I-749)+(2.043)+(15.008), (I-749)+(2.043)+(15.011), (I-749)+(2.043)+(15.012), (I-749)+(2.043)+(15.016), (I-749)+(2.043)+(15.025), (I-749)+(2.043)+(15.027), (I-749)+(2.043)+(15.047), (I-749)+(2.043)+(15.063), (I-749)+(2.043)+(15.064), (I-749)+(2.043)+(16.001), (I-749)+(2.043)+(16.002), (I-749)+(2.043)+(16.003), (I-749)+(2.043)+(16.004), (I-749)+(2.043)+(16.005), (I-749)+(2.043)+(16.006), (I-749)+(2.043)+(16.007), (I-749)+(2.043)+(16.008), (I-749)+(2.043)+(17.001), (I-749)+(2.043)+(17.002), (I-749)+(2.043)+(17.003), (I-749)+(2.043)+(17.004), (I-749)+(2.043)+(17.005), (I-749)+(2.043)+(17.006), (I-749)+(2.043)+(17.007), (I-749)+(2.043)+(17.008), (I-749)+(2.043)+(17.009), (I-749)+(2.043)+(17.010), (I-749)+(2.043)+(17.011), (I-749)+(2.043)+(17.012), (I-749)+(2.043)+(18.001),

(I-749)+(2.044)+(3.001), (I-749)+(2.044)+(3.002), (I-749)+(2.044)+(3.003), (I-749)+(2.044)+(3.004), (I-749)+(2.044)+(3.005), (I-749)+(2.044)+(3.006), (I-749)+(2.044)+(3.007), (I-749)+(2.044)+(3.008), (I-749)+(2.044)+(3.009), (I-749)+(2.044)+(3.010), (I-749)+(2.044)+(3.011), (I-749)+(2.044)+(3.012), (I-749)+(2.044)+(3.013), (I-749)+(2.044)+(3.014), (I-749)+(2.044)+(3.015), (I-749)+(2.044)+(3.016), (I-749)+(2.044)+(3.017), (I-749)+(2.044)+(3.018), (I-749)+(2.044)+(3.019), (I-749)+(2.044)+(3.020), (I-749)+(2.044)+(3.021), (I-749)+(2.044)+(3.022), (I-749)+(2.044)+(3.023), (I-749)+(2.044)+(3.024), (I-749)+(2.044)+(3.025), (I-749)+(2.044)+(3.026), (I-749)+(2.044)+(3.027), (I-749)+(2.044)+(3.028), (I-749)+(2.044)+(3.029), (I-749)+(2.044)+(3.030), (I-749)+(2.044)+(3.031), (I-749)+(2.044)+(5.001), (I-749)+(2.044)+(5.002), (I-749)+(2.044)+(5.003), (I-749)+(2.044)+(5.004), (I-749)+(2.044)+(5.005), (I-749)+(2.044)+(5.006), (I-749)+(2.044)+(5.007), (I-749)+(2.044)+(5.008), (I-749)+(2.044)+(5.009), (I-749)+(2.044)+(5.010), (I-749)+(2.044)+(5.011), (I-749)+(2.044)+(5.012), (I-749)+(2.044)+(5.013), (I-749)+(2.044)+(5.014), (I-749)+(2.044)+(5.015), (I-749)+(2.044)+(5.016), (I-749)+(2.044)+(5.017), (I-749)+(2.044)+(5.018), (I-749)+(2.044)+(5.019), (I-749)+(2.044)+(5.020), (I-749)+(2.044)+(5.021), (I-749)+(2.044)+(5.022), (I-749)+(2.044)+(5.023), (I-749)+(2.044)+(6.001), (I-749)+(2.044)+(6.002), (I-749)+(2.044)+(6.003), (I-749)+(2.044)+(6.004), (I-749)+(2.044)+(7.001), (I-749)+(2.044)+(7.002), (I-749)+(2.044)+(7.003), (I-749)+(2.044)+(7.004), (I-749)+(2.044)+(7.005), (I-749)+(2.044)+(7.006), (I-749)+(2.044)+(9.001), (I-749)+(2.044)+(9.002), (I-749)+(2.044)+(9.003), (I-749)+(2.044)+(9.004), (I-749)+(2.044)+(9.005), (I-749)+(2.044)+(9.006), (I-749)+(2.044)+(9.007), (I-749)+(2.044)+(9.008), (I-749)+(2.044)+(9.009), (I-749)+(2.044)+(14.001), (I-749)+(2.044)+(14.002), (I-749)+(2.044)+(15.008), (I-749)+(2.044)+(15.011), (I-749)+(2.044)+(15.012), (I-749)+(2.044)+(15.016), (I-749)+(2.044)+(15.025), (I-749)+(2.044)+(15.027), (I-749)+(2.044)+(15.047), (I-749)+(2.044)+(15.063), (I-749)+(2.044)+(15.064), (I-749)+(2.044)+(16.001), (I-749)+(2.044)+(16.002), (I-749)+(2.044)+(16.003), (I-749)+(2.044)+(16.004), (I-749)+(2.044)+(16.005), (I-749)+(2.044)+(16.006), (I-749)+(2.044)+(16.007), (I-749)+(2.044)+(16.008), (I-749)+(2.044)+(17.001), (I-749)+(2.044)+(17.002), (I-749)+(2.044)+(17.003), (I-749)+(2.044)+(17.004), (I-749)+(2.044)+(17.005), (I-749)+(2.044)+(17.006), (I-749)+(2.044)+(17.007), (I-749)+(2.044)+(17.008), (I-749)+(2.044)+(17.009), (I-749)+(2.044)+(17.010), (I-749)+(2.044)+(17.011), (I-749)+(2.044)+(17.012), (I-749)+(2.044)+(18.001),

(I-749)+(2.045)+(3.001), (I-749)+(2.045)+(3.002), (I-749)+(2.045)+(3.003), (I-749)+(2.045)+(3.004), (I-749)+(2.045)+(3.005), (I-749)+(2.045)+(3.006), (I-749)+(2.045)+(3.007), (I-749)+(2.045)+(3.008), (I-749)+(2.045)+(3.009), (I-749)+(2.045)+(3.010), (I-749)+(2.045)+(3.011), (I-749)+(2.045)+(3.012), (I-749)+(2.045)+(3.013), (I-749)+(2.045)+(3.014), (I-749)+(2.045)+(3.015), (I-749)+(2.045)+(3.016), (I-749)+(2.045)+(3.017), (I-749)+(2.045)+(3.018), (I-749)+(2.045)+(3.019), (I-749)+(2.045)+(3.020), (I-749)+(2.045)+(3.021), (I-749)+(2.045)+(3.022), (I-749)+(2.045)+(3.023), (I-749)+(2.045)+(3.024), (I-749)+(2.045)+(3.025), (I-749)+(2.045)+(3.026), (I-749)+(2.045)+(3.027), (I-749)+(2.045)+(3.028), (I-749)+(2.045)+(3.029), (I-749)+(2.045)+(3.030), (I-749)+(2.045)+(3.031), (I-749)+(2.045)+(5.001), (I-749)+(2.045)+(5.002), (I-749)+(2.045)+(5.003), (I-749)+(2.045)+(5.004), (I-749)+(2.045)+(5.005), (I-749)+(2.045)+(5.006), (I-749)+(2.045)+(5.007), (I-749)+(2.045)+(5.008), (I-749)+(2.045)+(5.009), (I-749)+(2.045)+(5.010), (I-749)+(2.045)+(5.011), (I-749)+(2.045)+(5.012), (I-749)+(2.045)+(5.013), (I-749)+(2.045)+(5.014), (I-749)+(2.045)+(5.015), (I-749)+(2.045)+(5.016), (I-749)+(2.045)+(5.017), (I-749)+(2.045)+(5.018), (I-749)+(2.045)+(5.019), (I-749)+(2.045)+(5.020), (I-749)+(2.045)+(5.021), (I-749)+(2.045)+(5.022), (I-749)+(2.045)+(5.023), (I-749)+(2.045)+(6.001), (I-749)+(2.045)+(6.002), (I-749)+(2.045)+(6.003), (I-749)+(2.045)+(6.004), (I-749)+(2.045)+(7.001), (I-749)+(2.045)+(7.002), (I-749)+(2.045)+(7.003), (I-749)+(2.045)+(7.004), (I-749)+(2.045)+(7.005), (I-749)+(2.045)+(7.006), (I-749)+(2.045)+(9.001), (I-749)+(2.045)+(9.002), (I-749)+(2.045)+(9.003), (I-749)+(2.045)+(9.004), (I-749)+(2.045)+(9.005), (I-749)+(2.045)+(9.006), (I-749)+(2.045)+(9.007), (I-749)+(2.045)+(9.008), (I-749)+(2.045)+(9.009), (I-749)+(2.045)+(14.001), (I-749)+(2.045)+(14.002), (I-749)+(2.045)+(15.008), (I-749)+(2.045)+(15.011), (I-749)+(2.045)+(15.012), (I-749)+(2.045)+(15.016), (I-749)+(2.045)+(15.025), (I-749)+(2.045)+(15.027), (I-749)+(2.045)+(15.047), (I-749)+(2.045)+(15.063), (I-749)+(2.045)+(15.064), (I-749)+(2.045)+(16.001), (I-749)+(2.045)+(16.002), (I-749)+(2.045)+(16.003), (I-749)+(2.045)+(16.004), (I-749)+(2.045)+(16.005), (I-749)+(2.045)+(16.006), (I-749)+(2.045)+(16.007), (I-749)+(2.045)+(16.008), (I-749)+(2.045)+(17.001), (I-749)+(2.045)+(17.002), (I-749)+(2.045)+(17.003), (I-749)+(2.045)+(17.004), (I-749)+(2.045)+(17.005), (I-749)+(2.045)+(17.006), (I-749)+(2.045)+(17.007), (I-749)+(2.045)+(17.008), (I-749)+(2.045)+(17.009), (I-749)+(2.045)+(17.010), (I-749)+(2.045)+(17.011), (I-749)+(2.045)+(17.012), (I-749)+(2.045)+(18.001),

(I-749)+(2.046)+(3.001), (I-749)+(2.046)+(3.002), (I-749)+(2.046)+(3.003), (I-749)+(2.046)+(3.004), (I-749)+(2.046)+(3.005), (I-749)+(2.046)+(3.006), (I-749)+(2.046)+(3.007), (I-749)+(2.046)+(3.008), (I-749)+(2.046)+(3.009), (I-749)+(2.046)+(3.010), (I-749)+(2.046)+(3.011), (I-749)+(2.046)+(3.012), (I-749)+(2.046)+(3.013), (I-749)+(2.046)+(3.014), (I-749)+(2.046)+(3.015), (I-749)+(2.046)+(3.016), (I-749)+(2.046)+(3.017), (I-749)+(2.046)+(3.018), (I-749)+(2.046)+(3.019), (I-749)+(2.046)+(3.020), (I-749)+(2.046)+(3.021), (I-749)+(2.046)+(3.022), (I-749)+(2.046)+(3.023), (I-749)+(2.046)+(3.024), (I-749)+(2.046)+(3.025), (I-749)+(2.046)+(3.026), (I-749)+(2.046)+(3.027), (I-749)+(2.046)+(3.028), (I-749)+(2.046)+(3.029), (I-749)+(2.046)+(3.030), (I-749)+(2.046)+(3.031), (I-749)+(2.046)+(5.001), (I-749)+(2.046)+(5.002), (I-749)+(2.046)+(5.003), (I-749)+(2.046)+(5.004), (I-749)+(2.046)+(5.005), (I-749)+(2.046)+(5.006), (I-749)+(2.046)+(5.007), (I-749)+(2.046)+(5.008), (I-749)+(2.046)+(5.009), (I-749)+(2.046)+(5.010), (I-749)+(2.046)+(5.011), (I-749)+(2.046)+(5.012), (I-749)+(2.046)+(5.013), (I-749)+(2.046)+(5.014), (I-749)+(2.046)+(5.015), (I-749)+(2.046)+(5.016), (I-749)+(2.046)+(5.017), (I-749)+(2.046)+(5.018), (I-749)+(2.046)+(5.019), (I-749)+(2.046)+(5.020), (I-749)+(2.046)+(5.021), (I-749)+(2.046)+(5.022), (I-749)+(2.046)+(5.023), (I-749)+(2.046)+(6.001), (I-749)+(2.046)+(6.002), (I-749)+(2.046)+(6.003), (I-749)+(2.046)+(6.004), (I-749)+(2.046)+(7.001), (I-749)+(2.046)+(7.002), (I-749)+(2.046)+(7.003), (I-749)+(2.046)+(7.004), (I-749)+(2.046)+(7.005), (I-749)+(2.046)+(7.006), (I-749)+(2.046)+(9.001), (I-749)+(2.046)+(9.002), (I-749)+(2.046)+(9.003), (I-749)+(2.046)+(9.004), (I-749)+(2.046)+(9.005), (I-749)+(2.046)+(9.006), (I-749)+(2.046)+(9.007), (I-749)+(2.046)+(9.008), (I-749)+(2.046)+(9.009), (I-749)+(2.046)+(14.001), (I-749)+(2.046)+(14.002), (I-749)+(2.046)+(15.008), (I-749)+(2.046)+(15.011), (I-749)+(2.046)+(15.012), (I-749)+(2.046)+(15.016), (I-749)+(2.046)+(15.025), (I-749)+(2.046)+(15.027), (I-749)+(2.046)+(15.047), (I-749)+(2.046)+(15.063), (I-749)+(2.046)+(15.064), (I-749)+(2.046)+(16.001), (I-749)+(2.046)+(16.002), (I-749)+(2.046)+(16.003), (I-749)+(2.046)+(16.004), (I-749)+(2.046)+(16.005), (I-749)+(2.046)+(16.006), (I-749)+(2.046)+(16.007), (I-749)+(2.046)+(16.008), (I-749)+(2.046)+(17.001), (I-749)+(2.046)+(17.002), (I-749)+(2.046)+(17.003), (I-749)+(2.046)+(17.004), (I-749)+(2.046)+(17.005), (I-749)+(2.046)+(17.006), (I-749)+(2.046)+(17.007), (I-749)+(2.046)+(17.008), (I-749)+(2.046)+(17.009), (I-749)+(2.046)+(17.010), (I-749)+(2.046)+(17.011), (I-749)+(2.046)+(17.012), (I-749)+(2.046)+(18.001),

(I-749)+(2.047)+(3.001), (I-749)+(2.047)+(3.002), (I-749)+(2.047)+(3.003), (I-749)+(2.047)+(3.004), (I-749)+(2.047)+(3.005), (I-749)+(2.047)+(3.006), (I-749)+(2.047)+(3.007), (I-749)+(2.047)+(3.008), (I-749)+(2.047)+(3.009), (I-749)+(2.047)+(3.010), (I-749)+(2.047)+(3.011), (I-749)+(2.047)+(3.012), (I-749)+(2.047)+(3.013), (I-749)+(2.047)+(3.014), (I-749)+(2.047)+(3.015), (I-749)+(2.047)+(3.016), (I-749)+(2.047)+(3.017), (I-749)+(2.047)+(3.018), (I-749)+(2.047)+(3.019), (I-749)+(2.047)+(3.020), (I-749)+(2.047)+(3.021), (I-749)+(2.047)+(3.022), (I-749)+(2.047)+(3.023), (I-749)+(2.047)+(3.024), (I-749)+(2.047)+(3.025), (I-749)+(2.047)+(3.026), (I-749)+(2.047)+(3.027), (I-749)+(2.047)+(3.028), (I-749)+(2.047)+(3.029), (I-749)+(2.047)+(3.030), (I-749)+(2.047)+(3.031), (I-749)+(2.047)+(5.001), (I-749)+(2.047)+(5.002), (I-749)+(2.047)+(5.003), (I-749)+(2.047)+(5.004), (I-749)+(2.047)+(5.005), (I-749)+(2.047)+(5.006), (I-749)+(2.047)+(5.007), (I-749)+(2.047)+(5.008), (I-749)+(2.047)+(5.009), (I-749)+(2.047)+(5.010), (I-749)+(2.047)+(5.011), (I-749)+(2.047)+(5.012), (I-749)+(2.047)+(5.013), (I-749)+(2.047)+(5.014), (I-749)+(2.047)+(5.015), (I-749)+(2.047)+(5.016), (I-749)+(2.047)+(5.017), (I-749)+(2.047)+(5.018), (I-749)+(2.047)+(5.019), (I-749)+(2.047)+(5.020), (I-749)+(2.047)+(5.021), (I-749)+(2.047)+(5.022), (I-749)+(2.047)+(5.023), (I-749)+(2.047)+(6.001), (I-749)+(2.047)+(6.002), (I-749)+(2.047)+(6.003), (I-749)+(2.047)+(6.004), (I-749)+(2.047)+(7.001), (I-749)+(2.047)+(7.002), (I-749)+(2.047)+(7.003), (I-749)+(2.047)+(7.004), (I-749)+(2.047)+(7.005), (I-749)+(2.047)+(7.006), (I-749)+(2.047)+(9.001), (I-749)+(2.047)+(9.002), (I-749)+(2.047)+(9.003), (I-749)+(2.047)+(9.004), (I-749)+(2.047)+(9.005), (I-749)+(2.047)+(9.006), (I-749)+(2.047)+(9.007), (I-749)+(2.047)+(9.008), (I-749)+(2.047)+(9.009), (I-749)+(2.047)+(14.001), (I-749)+(2.047)+(14.002), (I-749)+(2.047)+(15.008), (I-749)+(2.047)+(15.011), (I-749)+(2.047)+(15.012), (I-749)+(2.047)+(15.016), (I-749)+(2.047)+(15.025), (I-749)+(2.047)+(15.027), (I-749)+(2.047)+(15.047), (I-749)+(2.047)+(15.063), (I-749)+(2.047)+(15.064), (I-749)+(2.047)+(16.001), (I-749)+(2.047)+(16.002), (I-749)+(2.047)+(16.003), (I-749)+(2.047)+(16.004), (I-749)+(2.047)+(16.005), (I-749)+(2.047)+(16.006), (I-749)+(2.047)+(16.007), (I-749)+(2.047)+(16.008), (I-749)+(2.047)+(17.001), (I-749)+(2.047)+(17.002), (I-749)+(2.047)+(17.003), (I-749)+(2.047)+(17.004), (I-749)+(2.047)+(17.005), (I-749)+(2.047)+(17.006), (I-749)+(2.047)+(17.007), (I-749)+(2.047)+(17.008), (I-749)+(2.047)+(17.009), (I-749)+(2.047)+(17.010), (I-749)+(2.047)+(17.011), (I-749)+(2.047)+(17.012), (I-749)+(2.047)+(18.001),

(I-749)+(2.048)+(3.001), (I-749)+(2.048)+(3.002), (I-749)+(2.048)+(3.003), (I-749)+(2.048)+(3.004), (I-749)+(2.048)+(3.005), (I-749)+(2.048)+(3.006), (I-749)+(2.048)+(3.007), (I-749)+(2.048)+(3.008), (I-749)+(2.048)+(3.009), (I-749)+(2.048)+(3.010), (I-749)+(2.048)+(3.011), (I-749)+(2.048)+(3.012), (I-749)+(2.048)+(3.013), (I-749)+(2.048)+(3.014), (I-749)+(2.048)+(3.015), (I-749)+(2.048)+(3.016), (I-749)+(2.048)+(3.017), (I-749)+(2.048)+(3.018), (I-749)+(2.048)+(3.019), (I-749)+(2.048)+(3.020), (I-749)+(2.048)+(3.021), (I-749)+(2.048)+(3.022), (I-749)+(2.048)+(3.023), (I-749)+(2.048)+(3.024), (I-749)+(2.048)+(3.025), (I-749)+(2.048)+(3.026), (I-749)+(2.048)+(3.027), (I-749)+(2.048)+(3.028), (I-749)+(2.048)+(3.029), (I-749)+(2.048)+(3.030), (I-749)+(2.048)+(3.031), (I-749)+(2.048)+(5.001), (I-749)+(2.048)+(5.002), (I-749)+(2.048)+(5.003), (I-749)+(2.048)+(5.004), (I-749)+(2.048)+(5.005), (I-749)+(2.048)+(5.006), (I-749)+(2.048)+(5.007), (I-749)+(2.048)+(5.008), (I-749)+(2.048)+(5.009), (I-749)+(2.048)+(5.010), (I-749)+(2.048)+(5.011), (I-749)+(2.048)+(5.012), (I-749)+(2.048)+(5.013), (I-749)+(2.048)+(5.014), (I-749)+(2.048)+(5.015), (I-749)+(2.048)+(5.016), (I-749)+(2.048)+(5.017), (I-749)+(2.048)+(5.018), (I-749)+(2.048)+(5.019), (I-749)+(2.048)+(5.020), (I-749)+(2.048)+(5.021), (I-749)+(2.048)+(5.022), (I-749)+(2.048)+(5.023), (I-749)+(2.048)+(6.001), (I-749)+(2.048)+(6.002), (I-749)+(2.048)+(6.003), (I-749)+(2.048)+(6.004), (I-749)+(2.048)+(7.001), (I-749)+(2.048)+(7.002), (I-749)+(2.048)+(7.003), (I-749)+(2.048)+(7.004), (I-749)+(2.048)+(7.005), (I-749)+(2.048)+(7.006), (I-749)+(2.048)+(9.001), (I-749)+(2.048)+(9.002), (I-749)+(2.048)+(9.003), (I-749)+(2.048)+(9.004), (I-749)+(2.048)+(9.005), (I-749)+(2.048)+(9.006), (I-749)+(2.048)+(9.007), (I-749)+(2.048)+(9.008), (I-749)+(2.048)+(9.009), (I-749)+(2.048)+(14.001), (I-749)+(2.048)+(14.002), (I-749)+(2.048)+(15.008), (I-749)+(2.048)+(15.011), (I-749)+(2.048)+(15.012), (I-749)+(2.048)+(15.016), (I-749)+(2.048)+(15.025), (I-749)+(2.048)+(15.027), (I-749)+(2.048)+(15.047), (I-749)+(2.048)+(15.063), (I-749)+(2.048)+(15.064), (I-749)+(2.048)+(16.001), (I-749)+(2.048)+(16.002), (I-749)+(2.048)+(16.003), (I-749)+(2.048)+(16.004), (I-749)+(2.048)+(16.005), (I-749)+(2.048)+(16.006), (I-749)+(2.048)+(16.007), (I-749)+(2.048)+(16.008), (I-749)+(2.048)+(17.001), (I-749)+(2.048)+(17.002), (I-749)+(2.048)+(17.003), (I-749)+(2.048)+(17.004), (I-749)+(2.048)+(17.005), (I-749)+(2.048)+(17.006), (I-749)+(2.048)+(17.007), (I-749)+(2.048)+(17.008), (I-749)+(2.048)+(17.009), (I-749)+(2.048)+(17.010), (I-749)+(2.048)+(17.011), (I-749)+(2.048)+(17.012), (I-749)+(2.048)+(18.001),

(I-749)+(2.049)+(3.001), (I-749)+(2.049)+(3.002), (I-749)+(2.049)+(3.003), (I-749)+(2.049)+(3.004), (I-749)+(2.049)+(3.005), (I-749)+(2.049)+(3.006), (I-749)+(2.049)+(3.007), (I-749)+(2.049)+(3.008), (I-749)+(2.049)+(3.009), (I-749)+(2.049)+(3.010), (I-749)+(2.049)+(3.011), (I-749)+(2.049)+(3.012), (I-749)+(2.049)+(3.013), (I-749)+(2.049)+(3.014), (I-749)+(2.049)+(3.015), (I-749)+(2.049)+(3.016), (I-749)+(2.049)+(3.017), (I-749)+(2.049)+(3.018), (I-749)+(2.049)+(3.019), (I-749)+(2.049)+(3.020), (I-749)+(2.049)+(3.021), (I-749)+(2.049)+(3.022), (I-749)+(2.049)+(3.023), (I-749)+(2.049)+(3.024), (I-749)+(2.049)+(3.025), (I-749)+(2.049)+(3.026), (I-749)+(2.049)+(3.027), (I-749)+(2.049)+(3.028), (I-749)+(2.049)+(3.029), (I-749)+(2.049)+(3.030), (I-749)+(2.049)+(3.031), (I-749)+(2.049)+(5.001), (I-749)+(2.049)+(5.002), (I-749)+(2.049)+(5.003), (I-749)+(2.049)+(5.004), (I-749)+(2.049)+(5.005), (I-749)+(2.049)+(5.006), (I-749)+(2.049)+(5.007), (I-749)+(2.049)+(5.008), (I-749)+(2.049)+(5.009), (I-749)+(2.049)+(5.010), (I-749)+(2.049)+(5.011), (I-749)+(2.049)+(5.012), (I-749)+(2.049)+(5.013), (I-749)+(2.049)+(5.014), (I-749)+(2.049)+(5.015), (I-749)+(2.049)+(5.016), (I-749)+(2.049)+(5.017), (I-749)+(2.049)+(5.018), (I-749)+(2.049)+(5.019), (I-749)+(2.049)+(5.020), (I-749)+(2.049)+(5.021), (I-749)+(2.049)+(5.022), (I-749)+(2.049)+(5.023), (I-749)+(2.049)+(6.001), (I-749)+(2.049)+(6.002), (I-749)+(2.049)+(6.003), (I-749)+(2.049)+(6.004), (I-749)+(2.049)+(7.001), (I-749)+(2.049)+(7.002), (I-749)+(2.049)+(7.003), (I-749)+(2.049)+(7.004), (I-749)+(2.049)+(7.005), (I-749)+(2.049)+(7.006), (I-749)+(2.049)+(9.001), (I-749)+(2.049)+(9.002), (I-749)+(2.049)+(9.003), (I-749)+(2.049)+(9.004), (I-749)+(2.049)+(9.005), (I-749)+(2.049)+(9.006), (I-749)+(2.049)+(9.007), (I-749)+(2.049)+(9.008), (I-749)+(2.049)+(9.009), (I-749)+(2.049)+(14.001), (I-749)+(2.049)+(14.002), (I-749)+(2.049)+(15.008), (I-749)+(2.049)+(15.011), (I-749)+(2.049)+(15.012), (I-749)+(2.049)+(15.016), (I-749)+(2.049)+(15.025), (I-749)+(2.049)+(15.027), (I-749)+(2.049)+(15.047), (I-749)+(2.049)+(15.063), (I-749)+(2.049)+(15.064), (I-749)+(2.049)+(16.001), (I-749)+(2.049)+(16.002), (I-749)+(2.049)+(16.003), (I-749)+(2.049)+(16.004), (I-749)+(2.049)+(16.005), (I-749)+(2.049)+(16.006), (I-749)+(2.049)+(16.007), (I-749)+(2.049)+(16.008), (I-749)+(2.049)+(17.001), (I-749)+(2.049)+(17.002), (I-749)+(2.049)+(17.003), (I-749)+(2.049)+(17.004), (I-749)+(2.049)+(17.005), (I-749)+(2.049)+(17.006), (I-749)+(2.049)+(17.007), (I-749)+(2.049)+(17.008), (I-749)+(2.049)+(17.009), (I-749)+(2.049)+(17.010), (I-749)+(2.049)+(17.011), (I-749)+(2.049)+(17.012), (I-749)+(2.049)+(18.001),

(I-749)+(2.050)+(3.001), (I-749)+(2.050)+(3.002), (I-749)+(2.050)+(3.003), (I-749)+(2.050)+(3.004), (I-749)+(2.050)+(3.005), (I-749)+(2.050)+(3.006), (I-749)+(2.050)+(3.007), (I-749)+(2.050)+(3.008), (I-749)+(2.050)+(3.009), (I-749)+(2.050)+(3.010), (I-749)+(2.050)+(3.011), (I-749)+(2.050)+(3.012), (I-749)+(2.050)+(3.013), (I-749)+(2.050)+(3.014), (I-749)+(2.050)+(3.015), (I-749)+(2.050)+(3.016), (I-749)+(2.050)+(3.017), (I-749)+(2.050)+(3.018), (I-749)+(2.050)+(3.019), (I-749)+(2.050)+(3.020), (I-749)+(2.050)+(3.021), (I-749)+(2.050)+(3.022), (I-749)+(2.050)+(3.023), (I-749)+(2.050)+(3.024), (I-749)+(2.050)+(3.025), (I-749)+(2.050)+(3.026), (I-749)+(2.050)+(3.027), (I-749)+(2.050)+(3.028), (I-749)+(2.050)+(3.029), (I-749)+(2.050)+(3.030), (I-749)+(2.050)+(3.031), (I-749)+(2.050)+(5.001), (I-749)+(2.050)+(5.002), (I-749)+(2.050)+(5.003), (I-749)+(2.050)+(5.004), (I-749)+(2.050)+(5.005), (I-749)+(2.050)+(5.006), (I-749)+(2.050)+(5.007), (I-749)+(2.050)+(5.008), (I-749)+(2.050)+(5.009), (I-749)+(2.050)+(5.010), (I-749)+(2.050)+(5.011), (I-749)+(2.050)+(5.012), (I-749)+(2.050)+(5.013), (I-749)+(2.050)+(5.014), (I-749)+(2.050)+(5.015), (I-749)+(2.050)+(5.016), (I-749)+(2.050)+(5.017), (I-749)+(2.050)+(5.018), (I-749)+(2.050)+(5.019), (I-749)+(2.050)+(5.020), (I-749)+(2.050)+(5.021), (I-749)+(2.050)+(5.022), (I-749)+(2.050)+(5.023), (I-749)+(2.050)+(6.001), (I-749)+(2.050)+(6.002), (I-749)+(2.050)+(6.003), (I-749)+(2.050)+(6.004), (I-749)+(2.050)+(7.001), (I-749)+(2.050)+(7.002), (I-749)+(2.050)+(7.003), (I-749)+(2.050)+(7.004), (I-749)+(2.050)+(7.005), (I-749)+(2.050)+(7.006), (I-749)+(2.050)+(9.001), (I-749)+(2.050)+(9.002), (I-749)+(2.050)+(9.003), (I-749)+(2.050)+(9.004), (I-749)+(2.050)+(9.005), (I-749)+(2.050)+(9.006), (I-749)+(2.050)+(9.007), (I-749)+(2.050)+(9.008), (I-749)+(2.050)+(9.009), (I-749)+(2.050)+(14.001), (I-749)+(2.050)+(14.002), (I-749)+(2.050)+(15.008), (I-749)+(2.050)+(15.011), (I-749)+(2.050)+(15.012), (I-749)+(2.050)+(15.016), (I-749)+(2.050)+(15.025), (I-749)+(2.050)+(15.027), (I-749)+(2.050)+(15.047), (I-749)+(2.050)+(15.063), (I-749)+(2.050)+(15.064), (I-749)+(2.050)+(16.001), (I-749)+(2.050)+(16.002), (I-749)+(2.050)+(16.003), (I-749)+(2.050)+(16.004), (I-749)+(2.050)+(16.005), (I-749)+(2.050)+(16.006), (I-749)+(2.050)+(16.007), (I-749)+(2.050)+(16.008), (I-749)+(2.050)+(17.001), (I-749)+(2.050)+(17.002), (I-749)+(2.050)+(17.003), (I-749)+(2.050)+(17.004), (I-749)+(2.050)+(17.005), (I-749)+(2.050)+(17.006), (I-749)+(2.050)+(17.007), (I-749)+(2.050)+(17.008), (I-749)+(2.050)+(17.009), (I-749)+(2.050)+(17.010), (I-749)+(2.050)+(17.011), (I-749)+(2.050)+(17.012), (I-749)+(2.050)+(18.001),

(I-749)+(2.051)+(3.001), (I-749)+(2.051)+(3.002), (I-749)+(2.051)+(3.003), (I-749)+(2.051)+(3.004), (I-749)+(2.051)+(3.005), (I-749)+(2.051)+(3.006), (I-749)+(2.051)+(3.007), (I-749)+(2.051)+(3.008), (I-749)+(2.051)+(3.009), (I-749)+(2.051)+(3.010), (I-749)+(2.051)+(3.011), (I-749)+(2.051)+(3.012), (I-749)+(2.051)+(3.013), (I-749)+(2.051)+(3.014), (I-749)+(2.051)+(3.015), (I-749)+(2.051)+(3.016), (I-749)+(2.051)+(3.017), (I-749)+(2.051)+(3.018), (I-749)+(2.051)+(3.019), (I-749)+(2.051)+(3.020), (I-749)+(2.051)+(3.021), (I-749)+(2.051)+(3.022), (I-749)+(2.051)+(3.023), (I-749)+(2.051)+(3.024), (I-749)+(2.051)+(3.025), (I-749)+(2.051)+(3.026), (I-749)+(2.051)+(3.027), (I-749)+(2.051)+(3.028), (I-749)+(2.051)+(3.029), (I-749)+(2.051)+(3.030), (I-749)+(2.051)+(3.031), (I-749)+(2.051)+(5.001), (I-749)+(2.051)+(5.002), (I-749)+(2.051)+(5.003), (I-749)+(2.051)+(5.004), (I-749)+(2.051)+(5.005), (I-749)+(2.051)+(5.006), (I-749)+(2.051)+(5.007), (I-749)+(2.051)+(5.008), (I-749)+(2.051)+(5.009), (I-749)+(2.051)+(5.010), (I-749)+(2.051)+(5.011), (I-749)+(2.051)+(5.012), (I-749)+(2.051)+(5.013), (I-749)+(2.051)+(5.014), (I-749)+(2.051)+(5.015), (I-749)+(2.051)+(5.016), (I-749)+(2.051)+(5.017), (I-749)+(2.051)+(5.018), (I-749)+(2.051)+(5.019), (I-749)+(2.051)+(5.020), (I-749)+(2.051)+(5.021), (I-749)+(2.051)+(5.022), (I-749)+(2.051)+(5.023), (I-749)+(2.051)+(6.001), (I-749)+(2.051)+(6.002), (I-749)+(2.051)+(6.003), (I-749)+(2.051)+(6.004), (I-749)+(2.051)+(7.001), (I-749)+(2.051)+(7.002), (I-749)+(2.051)+(7.003), (I-749)+(2.051)+(7.004), (I-749)+(2.051)+(7.005), (I-749)+(2.051)+(7.006), (I-749)+(2.051)+(9.001), (I-749)+(2.051)+(9.002), (I-749)+(2.051)+(9.003), (I-749)+(2.051)+(9.004), (I-749)+(2.051)+(9.005), (I-749)+(2.051)+(9.006), (I-749)+(2.051)+(9.007), (I-749)+(2.051)+(9.008), (I-749)+(2.051)+(9.009), (I-749)+(2.051)+(14.001), (I-749)+(2.051)+(14.002), (I-749)+(2.051)+(15.008), (I-749)+(2.051)+(15.011), (I-749)+(2.051)+(15.012), (I-749)+(2.051)+(15.016), (I-749)+(2.051)+(15.025), (I-749)+(2.051)+(15.027), (I-749)+(2.051)+(15.047), (I-749)+(2.051)+(15.063), (I-749)+(2.051)+(15.064), (I-749)+(2.051)+(16.001), (I-749)+(2.051)+(16.002), (I-749)+(2.051)+(16.003), (I-749)+(2.051)+(16.004), (I-749)+(2.051)+(16.005), (I-749)+(2.051)+(16.006), (I-749)+(2.051)+(16.007), (I-749)+(2.051)+(16.008), (I-749)+(2.051)+(17.001), (I-749)+(2.051)+(17.002), (I-749)+(2.051)+(17.003), (I-749)+(2.051)+(17.004), (I-749)+(2.051)+(17.005), (I-749)+(2.051)+(17.006), (I-749)+(2.051)+(17.007), (I-749)+(2.051)+(17.008), (I-749)+(2.051)+(17.009), (I-749)+(2.051)+(17.010), (I-749)+(2.051)+(17.011), (I-749)+(2.051)+(17.012), (I-749)+(2.051)+(18.001),

(I-749)+(2.052)+(3.001), (I-749)+(2.052)+(3.002), (I-749)+(2.052)+(3.003), (I-749)+(2.052)+(3.004), (I-749)+(2.052)+(3.005), (I-749)+(2.052)+(3.006), (I-749)+(2.052)+(3.007), (I-749)+(2.052)+(3.008), (I-749)+(2.052)+(3.009), (I-749)+(2.052)+(3.010), (I-749)+(2.052)+(3.011), (I-749)+(2.052)+(3.012), (I-749)+(2.052)+(3.013), (I-749)+(2.052)+(3.014), (I-749)+(2.052)+(3.015), (I-749)+(2.052)+(3.016), (I-749)+(2.052)+(3.017), (I-749)+(2.052)+(3.018), (I-749)+(2.052)+(3.019), (I-749)+(2.052)+(3.020), (I-749)+(2.052)+(3.021), (I-749)+(2.052)+(3.022), (I-749)+(2.052)+(3.023), (I-749)+(2.052)+(3.024), (I-749)+(2.052)+(3.025), (I-749)+(2.052)+(3.026), (I-749)+(2.052)+(3.027), (I-749)+(2.052)+(3.028), (I-749)+(2.052)+(3.029), (I-749)+(2.052)+(3.030), (I-749)+(2.052)+(3.031), (I-749)+(2.052)+(5.001), (I-749)+(2.052)+(5.002), (I-749)+(2.052)+(5.003), (I-749)+(2.052)+(5.004), (I-749)+(2.052)+(5.005), (I-749)+(2.052)+(5.006), (I-749)+(2.052)+(5.007), (I-749)+(2.052)+(5.008), (I-749)+(2.052)+(5.009), (I-749)+(2.052)+(5.010), (I-749)+(2.052)+(5.011), (I-749)+(2.052)+(5.012), (I-749)+(2.052)+(5.013), (I-749)+(2.052)+(5.014), (I-749)+(2.052)+(5.015), (I-749)+(2.052)+(5.016), (I-749)+(2.052)+(5.017), (I-749)+(2.052)+(5.018), (I-749)+(2.052)+(5.019), (I-749)+(2.052)+(5.020), (I-749)+(2.052)+(5.021), (I-749)+(2.052)+(5.022), (I-749)+(2.052)+(5.023), (I-749)+(2.052)+(6.001), (I-749)+(2.052)+(6.002), (I-749)+(2.052)+(6.003), (I-749)+(2.052)+(6.004), (I-749)+(2.052)+(7.001), (I-749)+(2.052)+(7.002), (I-749)+(2.052)+(7.003), (I-749)+(2.052)+(7.004), (I-749)+(2.052)+(7.005), (I-749)+(2.052)+(7.006), (I-749)+(2.052)+(9.001), (I-749)+(2.052)+(9.002), (I-749)+(2.052)+(9.003), (I-749)+(2.052)+(9.004), (I-749)+(2.052)+(9.005), (I-749)+(2.052)+(9.006), (I-749)+(2.052)+(9.007), (I-749)+(2.052)+(9.008), (I-749)+(2.052)+(9.009), (I-749)+(2.052)+(14.001), (I-749)+(2.052)+(14.002), (I-749)+(2.052)+(15.008), (I-749)+(2.052)+(15.011), (I-749)+(2.052)+(15.012), (I-749)+(2.052)+(15.016), (I-749)+(2.052)+(15.025), (I-749)+(2.052)+(15.027), (I-749)+(2.052)+(15.047), (I-749)+(2.052)+(15.063), (I-749)+(2.052)+(15.064), (I-749)+(2.052)+(16.001), (I-749)+(2.052)+(16.002), (I-749)+(2.052)+(16.003), (I-749)+(2.052)+(16.004), (I-749)+(2.052)+(16.005), (I-749)+(2.052)+(16.006), (I-749)+(2.052)+(16.007), (I-749)+(2.052)+(16.008), (I-749)+(2.052)+(17.001), (I-749)+(2.052)+(17.002), (I-749)+(2.052)+(17.003), (I-749)+(2.052)+(17.004), (I-749)+(2.052)+(17.005), (I-749)+(2.052)+(17.006), (I-749)+(2.052)+(17.007), (I-749)+(2.052)+(17.008), (I-749)+(2.052)+(17.009), (I-749)+(2.052)+(17.010), (I-749)+(2.052)+(17.011), (I-749)+(2.052)+(17.012), (I-749)+(2.052)+(18.001),

(I-749)+(2.053)+(3.001), (I-749)+(2.053)+(3.002), (I-749)+(2.053)+(3.003), (I-749)+(2.053)+(3.004), (I-749)+(2.053)+(3.005), (I-749)+(2.053)+(3.006), (I-749)+(2.053)+(3.007), (I-749)+(2.053)+(3.008), (I-749)+(2.053)+(3.009), (I-749)+(2.053)+(3.010), (I-749)+(2.053)+(3.011), (I-749)+(2.053)+(3.012), (I-749)+(2.053)+(3.013), (I-749)+(2.053)+(3.014), (I-749)+(2.053)+(3.015), (I-749)+(2.053)+(3.016), (I-749)+(2.053)+(3.017), (I-749)+(2.053)+(3.018), (I-749)+(2.053)+(3.019), (I-749)+(2.053)+(3.020), (I-749)+(2.053)+(3.021), (I-749)+(2.053)+(3.022), (I-749)+(2.053)+(3.023), (I-749)+(2.053)+(3.024), (I-749)+(2.053)+(3.025), (I-749)+(2.053)+(3.026), (I-749)+(2.053)+(3.027), (I-749)+(2.053)+(3.028), (I-749)+(2.053)+(3.029), (I-749)+(2.053)+(3.030), (I-749)+(2.053)+(3.031), (I-749)+(2.053)+(5.001), (I-749)+(2.053)+(5.002), (I-749)+(2.053)+(5.003), (I-749)+(2.053)+(5.004), (I-749)+(2.053)+(5.005), (I-749)+(2.053)+(5.006), (I-749)+(2.053)+(5.007), (I-749)+(2.053)+(5.008), (I-749)+(2.053)+(5.009), (I-749)+(2.053)+(5.010), (I-749)+(2.053)+(5.011), (I-749)+(2.053)+(5.012), (I-749)+(2.053)+(5.013), (I-749)+(2.053)+(5.014), (I-749)+(2.053)+(5.015), (I-749)+(2.053)+(5.016), (I-749)+(2.053)+(5.017), (I-749)+(2.053)+(5.018), (I-749)+(2.053)+(5.019), (I-749)+(2.053)+(5.020), (I-749)+(2.053)+(5.021), (I-749)+(2.053)+(5.022), (I-749)+(2.053)+(5.023), (I-749)+(2.053)+(6.001), (I-749)+(2.053)+(6.002), (I-749)+(2.053)+(6.003), (I-749)+(2.053)+(6.004), (I-749)+(2.053)+(7.001), (I-749)+(2.053)+(7.002), (I-749)+(2.053)+(7.003), (I-749)+(2.053)+(7.004), (I-749)+(2.053)+(7.005), (I-749)+(2.053)+(7.006), (I-749)+(2.053)+(9.001), (I-749)+(2.053)+(9.002), (I-749)+(2.053)+(9.003), (I-749)+(2.053)+(9.004), (I-749)+(2.053)+(9.005), (I-749)+(2.053)+(9.006), (I-749)+(2.053)+(9.007), (I-749)+(2.053)+(9.008), (I-749)+(2.053)+(9.009), (I-749)+(2.053)+(14.001), (I-749)+(2.053)+(14.002), (I-749)+(2.053)+(15.008), (I-749)+(2.053)+(15.011), (I-749)+(2.053)+(15.012), (I-749)+(2.053)+(15.016), (I-749)+(2.053)+(15.025), (I-749)+(2.053)+(15.027), (I-749)+(2.053)+(15.047), (I-749)+(2.053)+(15.063), (I-749)+(2.053)+(15.064), (I-749)+(2.053)+(16.001), (I-749)+(2.053)+(16.002), (I-749)+(2.053)+(16.003), (I-749)+(2.053)+(16.004), (I-749)+(2.053)+(16.005), (I-749)+(2.053)+(16.006), (I-749)+(2.053)+(16.007), (I-749)+(2.053)+(16.008), (I-749)+(2.053)+(17.001), (I-749)+(2.053)+(17.002), (I-749)+(2.053)+(17.003), (I-749)+(2.053)+(17.004), (I-749)+(2.053)+(17.005), (I-749)+(2.053)+(17.006), (I-749)+(2.053)+(17.007), (I-749)+(2.053)+(17.008), (I-749)+(2.053)+(17.009), (I-749)+(2.053)+(17.010), (I-749)+(2.053)+(17.011), (I-749)+(2.053)+(17.012), (I-749)+(2.053)+(18.001),

(I-749)+(2.054)+(3.001), (I-749)+(2.054)+(3.002), (I-749)+(2.054)+(3.003), (I-749)+(2.054)+(3.004), (I-749)+(2.054)+(3.005), (I-749)+(2.054)+(3.006), (I-749)+(2.054)+(3.007), (I-749)+(2.054)+(3.008), (I-749)+(2.054)+(3.009), (I-749)+(2.054)+(3.010), (I-749)+(2.054)+(3.011), (I-749)+(2.054)+(3.012), (I-749)+(2.054)+(3.013), (I-749)+(2.054)+(3.014), (I-749)+(2.054)+(3.015), (I-749)+(2.054)+(3.016), (I-749)+(2.054)+(3.017), (I-749)+(2.054)+(3.018), (I-749)+(2.054)+(3.019), (I-749)+(2.054)+(3.020), (I-749)+(2.054)+(3.021), (I-749)+(2.054)+(3.022), (I-749)+(2.054)+(3.023), (I-749)+(2.054)+(3.024), (I-749)+(2.054)+(3.025), (I-749)+(2.054)+(3.026), (I-749)+(2.054)+(3.027), (I-749)+(2.054)+(3.028), (I-749)+(2.054)+(3.029), (I-749)+(2.054)+(3.030), (I-749)+(2.054)+(3.031), (I-749)+(2.054)+(5.001), (I-749)+(2.054)+(5.002), (I-749)+(2.054)+(5.003), (I-749)+(2.054)+(5.004), (I-749)+(2.054)+(5.005), (I-749)+(2.054)+(5.006), (I-749)+(2.054)+(5.007), (I-749)+(2.054)+(5.008), (I-749)+(2.054)+(5.009), (I-749)+(2.054)+(5.010), (I-749)+(2.054)+(5.011), (I-749)+(2.054)+(5.012), (I-749)+(2.054)+(5.013), (I-749)+(2.054)+(5.014), (I-749)+(2.054)+(5.015), (I-749)+(2.054)+(5.016), (I-749)+(2.054)+(5.017), (I-749)+(2.054)+(5.018), (I-749)+(2.054)+(5.019), (I-749)+(2.054)+(5.020), (I-749)+(2.054)+(5.021), (I-749)+(2.054)+(5.022), (I-749)+(2.054)+(5.023), (I-749)+(2.054)+(6.001), (I-749)+(2.054)+(6.002), (I-749)+(2.054)+(6.003), (I-749)+(2.054)+(6.004), (I-749)+(2.054)+(7.001), (I-749)+(2.054)+(7.002), (I-749)+(2.054)+(7.003), (I-749)+(2.054)+(7.004), (I-749)+(2.054)+(7.005), (I-749)+(2.054)+(7.006), (I-749)+(2.054)+(9.001), (I-749)+(2.054)+(9.002), (I-749)+(2.054)+(9.003), (I-749)+(2.054)+(9.004), (I-749)+(2.054)+(9.005), (I-749)+(2.054)+(9.006), (I-749)+(2.054)+(9.007), (I-749)+(2.054)+(9.008), (I-749)+(2.054)+(9.009), (I-749)+(2.054)+(14.001), (I-749)+(2.054)+(14.002), (I-749)+(2.054)+(15.008), (I-749)+(2.054)+(15.011), (I-749)+(2.054)+(15.012), (I-749)+(2.054)+(15.016), (I-749)+(2.054)+(15.025), (I-749)+(2.054)+(15.027), (I-749)+(2.054)+(15.047), (I-749)+(2.054)+(15.063), (I-749)+(2.054)+(15.064), (I-749)+(2.054)+(16.001), (I-749)+(2.054)+(16.002), (I-749)+(2.054)+(16.003), (I-749)+(2.054)+(16.004), (I-749)+(2.054)+(16.005), (I-749)+(2.054)+(16.006), (I-749)+(2.054)+(16.007), (I-749)+(2.054)+(16.008), (I-749)+(2.054)+(17.001), (I-749)+(2.054)+(17.002), (I-749)+(2.054)+(17.003), (I-749)+(2.054)+(17.004), (I-749)+(2.054)+(17.005), (I-749)+(2.054)+(17.006), (I-749)+(2.054)+(17.007), (I-749)+(2.054)+(17.008), (I-749)+(2.054)+(17.009), (I-749)+(2.054)+(17.010), (I-749)+(2.054)+(17.011), (I-749)+(2.054)+(17.012), (I-749)+(2.054)+(18.001),

(I-749)+(2.055)+(3.001), (I-749)+(2.055)+(3.002), (I-749)+(2.055)+(3.003), (I-749)+(2.055)+(3.004), (I-749)+(2.055)+(3.005), (I-749)+(2.055)+(3.006), (I-749)+(2.055)+(3.007), (I-749)+(2.055)+(3.008), (I-749)+(2.055)+(3.009), (I-749)+(2.055)+(3.010), (I-749)+(2.055)+(3.011), (I-749)+(2.055)+(3.012), (I-749)+(2.055)+(3.013), (I-749)+(2.055)+(3.014), (I-749)+(2.055)+(3.015), (I-749)+(2.055)+(3.016), (I-749)+(2.055)+(3.017), (I-749)+(2.055)+(3.018), (I-749)+(2.055)+(3.019), (I-749)+(2.055)+(3.020), (I-749)+(2.055)+(3.021), (I-749)+(2.055)+(3.022), (I-749)+(2.055)+(3.023), (I-749)+(2.055)+(3.024), (I-749)+(2.055)+(3.025), (I-749)+(2.055)+(3.026), (I-749)+(2.055)+(3.027), (I-749)+(2.055)+(3.028), (I-749)+(2.055)+(3.029), (I-749)+(2.055)+(3.030), (I-749)+(2.055)+(3.031), (I-749)+(2.055)+(5.001), (I-749)+(2.055)+(5.002), (I-749)+(2.055)+(5.003), (I-749)+(2.055)+(5.004), (I-749)+(2.055)+(5.005), (I-749)+(2.055)+(5.006), (I-749)+(2.055)+(5.007), (I-749)+(2.055)+(5.008), (I-749)+(2.055)+(5.009), (I-749)+(2.055)+(5.010), (I-749)+(2.055)+(5.011), (I-749)+(2.055)+(5.012), (I-749)+(2.055)+(5.013), (I-749)+(2.055)+(5.014), (I-749)+(2.055)+(5.015), (I-749)+(2.055)+(5.016), (I-749)+(2.055)+(5.017), (I-749)+(2.055)+(5.018), (I-749)+(2.055)+(5.019), (I-749)+(2.055)+(5.020), (I-749)+(2.055)+(5.021), (I-749)+(2.055)+(5.022), (I-749)+(2.055)+(5.023), (I-749)+(2.055)+(6.001), (I-749)+(2.055)+(6.002), (I-749)+(2.055)+(6.003), (I-749)+(2.055)+(6.004), (I-749)+(2.055)+(7.001), (I-749)+(2.055)+(7.002), (I-749)+(2.055)+(7.003), (I-749)+(2.055)+(7.004), (I-749)+(2.055)+(7.005), (I-749)+(2.055)+(7.006), (I-749)+(2.055)+(9.001), (I-749)+(2.055)+(9.002), (I-749)+(2.055)+(9.003), (I-749)+(2.055)+(9.004), (I-749)+(2.055)+(9.005), (I-749)+(2.055)+(9.006), (I-749)+(2.055)+(9.007), (I-749)+(2.055)+(9.008), (I-749)+(2.055)+(9.009), (I-749)+(2.055)+(14.001), (I-749)+(2.055)+(14.002), (I-749)+(2.055)+(15.008), (I-749)+(2.055)+(15.011), (I-749)+(2.055)+(15.012), (I-749)+(2.055)+(15.016), (I-749)+(2.055)+(15.025), (I-749)+(2.055)+(15.027), (I-749)+(2.055)+(15.047), (I-749)+(2.055)+(15.063), (I-749)+(2.055)+(15.064), (I-749)+(2.055)+(16.001), (I-749)+(2.055)+(16.002), (I-749)+(2.055)+(16.003), (I-749)+(2.055)+(16.004), (I-749)+(2.055)+(16.005), (I-749)+(2.055)+(16.006), (I-749)+(2.055)+(16.007), (I-749)+(2.055)+(16.008), (I-749)+(2.055)+(17.001), (I-749)+(2.055)+(17.002), (I-749)+(2.055)+(17.003), (I-749)+(2.055)+(17.004), (I-749)+(2.055)+(17.005), (I-749)+(2.055)+(17.006), (I-749)+(2.055)+(17.007), (I-749)+(2.055)+(17.008), (I-749)+(2.055)+(17.009), (I-749)+(2.055)+(17.010), (I-749)+(2.055)+(17.011), (I-749)+(2.055)+(17.012), (I-749)+(2.055)+(18.001),

(I-749)+(2.056)+(3.001), (I-749)+(2.056)+(3.002), (I-749)+(2.056)+(3.003), (I-749)+(2.056)+(3.004), (I-749)+(2.056)+(3.005), (I-749)+(2.056)+(3.006), (I-749)+(2.056)+(3.007), (I-749)+(2.056)+(3.008), (I-749)+(2.056)+(3.009), (I-749)+(2.056)+(3.010), (I-749)+(2.056)+(3.011), (I-749)+(2.056)+(3.012), (I-749)+(2.056)+(3.013), (I-749)+(2.056)+(3.014), (I-749)+(2.056)+(3.015), (I-749)+(2.056)+(3.016), (I-749)+(2.056)+(3.017), (I-749)+(2.056)+(3.018), (I-749)+(2.056)+(3.019), (I-749)+(2.056)+(3.020), (I-749)+(2.056)+(3.021), (I-749)+(2.056)+(3.022), (I-749)+(2.056)+(3.023), (I-749)+(2.056)+(3.024), (I-749)+(2.056)+(3.025), (I-749)+(2.056)+(3.026), (I-749)+(2.056)+(3.027), (I-749)+(2.056)+(3.028), (I-749)+(2.056)+(3.029), (I-749)+(2.056)+(3.030), (I-749)+(2.056)+(3.031), (I-749)+(2.056)+(5.001), (I-749)+(2.056)+(5.002), (I-749)+(2.056)+(5.003), (I-749)+(2.056)+(5.004), (I-749)+(2.056)+(5.005), (I-749)+(2.056)+(5.006), (I-749)+(2.056)+(5.007), (I-749)+(2.056)+(5.008), (I-749)+(2.056)+(5.009), (I-749)+(2.056)+(5.010), (I-749)+(2.056)+(5.011), (I-749)+(2.056)+(5.012), (I-749)+(2.056)+(5.013), (I-749)+(2.056)+(5.014), (I-749)+(2.056)+(5.015), (I-749)+(2.056)+(5.016), (I-749)+(2.056)+(5.017), (I-749)+(2.056)+(5.018), (I-749)+(2.056)+(5.019), (I-749)+(2.056)+(5.020), (I-749)+(2.056)+(5.021), (I-749)+(2.056)+(5.022), (I-749)+(2.056)+(5.023), (I-749)+(2.056)+(6.001), (I-749)+(2.056)+(6.002), (I-749)+(2.056)+(6.003), (I-749)+(2.056)+(6.004), (I-749)+(2.056)+(7.001), (I-749)+(2.056)+(7.002), (I-749)+(2.056)+(7.003), (I-749)+(2.056)+(7.004), (I-749)+(2.056)+(7.005), (I-749)+(2.056)+(7.006), (I-749)+(2.056)+(9.001), (I-749)+(2.056)+(9.002), (I-749)+(2.056)+(9.003), (I-749)+(2.056)+(9.004), (I-749)+(2.056)+(9.005), (I-749)+(2.056)+(9.006), (I-749)+(2.056)+(9.007), (I-749)+(2.056)+(9.008), (I-749)+(2.056)+(9.009), (I-749)+(2.056)+(14.001), (I-749)+(2.056)+(14.002), (I-749)+(2.056)+(15.008), (I-749)+(2.056)+(15.011), (I-749)+(2.056)+(15.012), (I-749)+(2.056)+(15.016), (I-749)+(2.056)+(15.025), (I-749)+(2.056)+(15.027), (I-749)+(2.056)+(15.047), (I-749)+(2.056)+(15.063), (I-749)+(2.056)+(15.064), (I-749)+(2.056)+(16.001), (I-749)+(2.056)+(16.002), (I-749)+(2.056)+(16.003), (I-749)+(2.056)+(16.004), (I-749)+(2.056)+(16.005), (I-749)+(2.056)+(16.006), (I-749)+(2.056)+(16.007), (I-749)+(2.056)+(16.008), (I-749)+(2.056)+(17.001), (I-749)+(2.056)+(17.002), (I-749)+(2.056)+(17.003), (I-749)+(2.056)+(17.004), (I-749)+(2.056)+(17.005), (I-749)+(2.056)+(17.006), (I-749)+(2.056)+(17.007), (I-749)+(2.056)+(17.008), (I-749)+(2.056)+(17.009), (I-749)+(2.056)+(17.010), (I-749)+(2.056)+(17.011), (I-749)+(2.056)+(17.012), (I-749)+(2.056)+(18.001),

(I-749)+(2.057)+(3.001), (I-749)+(2.057)+(3.002), (I-749)+(2.057)+(3.003), (I-749)+(2.057)+(3.004), (I-749)+(2.057)+(3.005), (I-749)+(2.057)+(3.006), (I-749)+(2.057)+(3.007), (I-749)+(2.057)+(3.008), (I-749)+(2.057)+(3.009), (I-749)+(2.057)+(3.010), (I-749)+(2.057)+(3.011), (I-749)+(2.057)+(3.012), (I-749)+(2.057)+(3.013), (I-749)+(2.057)+(3.014), (I-749)+(2.057)+(3.015), (I-749)+(2.057)+(3.016), (I-749)+(2.057)+(3.017), (I-749)+(2.057)+(3.018), (I-749)+(2.057)+(3.019), (I-749)+(2.057)+(3.020), (I-749)+(2.057)+(3.021), (I-749)+(2.057)+(3.022), (I-749)+(2.057)+(3.023), (I-749)+(2.057)+(3.024), (I-749)+(2.057)+(3.025), (I-749)+(2.057)+(3.026), (I-749)+(2.057)+(3.027), (I-749)+(2.057)+(3.028), (I-749)+(2.057)+(3.029), (I-749)+(2.057)+(3.030), (I-749)+(2.057)+(3.031), (I-749)+(2.057)+(5.001), (I-749)+(2.057)+(5.002), (I-749)+(2.057)+(5.003), (I-749)+(2.057)+(5.004), (I-749)+(2.057)+(5.005), (I-749)+(2.057)+(5.006), (I-749)+(2.057)+(5.007), (I-749)+(2.057)+(5.008), (I-749)+(2.057)+(5.009), (I-749)+(2.057)+(5.010), (I-749)+(2.057)+(5.011), (I-749)+(2.057)+(5.012), (I-749)+(2.057)+(5.013), (I-749)+(2.057)+(5.014), (I-749)+(2.057)+(5.015), (I-749)+(2.057)+(5.016), (I-749)+(2.057)+(5.017), (I-749)+(2.057)+(5.018), (I-749)+(2.057)+(5.019), (I-749)+(2.057)+(5.020), (I-749)+(2.057)+(5.021), (I-749)+(2.057)+(5.022), (I-749)+(2.057)+(5.023), (I-749)+(2.057)+(6.001), (I-749)+(2.057)+(6.002), (I-749)+(2.057)+(6.003), (I-749)+(2.057)+(6.004), (I-749)+(2.057)+(7.001), (I-749)+(2.057)+(7.002), (I-749)+(2.057)+(7.003), (I-749)+(2.057)+(7.004), (I-749)+(2.057)+(7.005), (I-749)+(2.057)+(7.006), (I-749)+(2.057)+(9.001), (I-749)+(2.057)+(9.002), (I-749)+(2.057)+(9.003), (I-749)+(2.057)+(9.004), (I-749)+(2.057)+(9.005), (I-749)+(2.057)+(9.006), (I-749)+(2.057)+(9.007), (I-749)+(2.057)+(9.008), (I-749)+(2.057)+(9.009), (I-749)+(2.057)+(14.001), (I-749)+(2.057)+(14.002), (I-749)+(2.057)+(15.008), (I-749)+(2.057)+(15.011), (I-749)+(2.057)+(15.012), (I-749)+(2.057)+(15.016), (I-749)+(2.057)+(15.025), (I-749)+(2.057)+(15.027), (I-749)+(2.057)+(15.047), (I-749)+(2.057)+(15.063), (I-749)+(2.057)+(15.064), (I-749)+(2.057)+(16.001), (I-749)+(2.057)+(16.002), (I-749)+(2.057)+(16.003), (I-749)+(2.057)+(16.004), (I-749)+(2.057)+(16.005), (I-749)+(2.057)+(16.006), (I-749)+(2.057)+(16.007), (I-749)+(2.057)+(16.008), (I-749)+(2.057)+(17.001), (I-749)+(2.057)+(17.002), (I-749)+(2.057)+(17.003), (I-749)+(2.057)+(17.004), (I-749)+(2.057)+(17.005), (I-749)+(2.057)+(17.006), (I-749)+(2.057)+(17.007), (I-749)+(2.057)+(17.008), (I-749)+(2.057)+(17.009), (I-749)+(2.057)+(17.010), (I-749)+(2.057)+(17.011), (I-749)+(2.057)+(17.012), (I-749)+(2.057)+(18.001),

(I-749)+(2.058)+(3.001), (I-749)+(2.058)+(3.002), (I-749)+(2.058)+(3.003), (I-749)+(2.058)+(3.004), (I-749)+(2.058)+(3.005), (I-749)+(2.058)+(3.006), (I-749)+(2.058)+(3.007), (I-749)+(2.058)+(3.008), (I-749)+(2.058)+(3.009), (I-749)+(2.058)+(3.010), (I-749)+(2.058)+(3.011), (I-749)+(2.058)+(3.012), (I-749)+(2.058)+(3.013), (I-749)+(2.058)+(3.014), (I-749)+(2.058)+(3.015), (I-749)+(2.058)+(3.016), (I-749)+(2.058)+(3.017), (I-749)+(2.058)+(3.018), (I-749)+(2.058)+(3.019), (I-749)+(2.058)+(3.020), (I-749)+(2.058)+(3.021), (I-749)+(2.058)+(3.022), (I-749)+(2.058)+(3.023), (I-749)+(2.058)+(3.024), (I-749)+(2.058)+(3.025), (I-749)+(2.058)+(3.026), (I-749)+(2.058)+(3.027), (I-749)+(2.058)+(3.028), (I-749)+(2.058)+(3.029), (I-749)+(2.058)+(3.030), (I-749)+(2.058)+(3.031), (I-749)+(2.058)+(5.001), (I-749)+(2.058)+(5.002), (I-749)+(2.058)+(5.003), (I-749)+(2.058)+(5.004), (I-749)+(2.058)+(5.005), (I-749)+(2.058)+(5.006), (I-749)+(2.058)+(5.007), (I-749)+(2.058)+(5.008), (I-749)+(2.058)+(5.009), (I-749)+(2.058)+(5.010), (I-749)+(2.058)+(5.011), (I-749)+(2.058)+(5.012), (I-749)+(2.058)+(5.013), (I-749)+(2.058)+(5.014), (I-749)+(2.058)+(5.015), (I-749)+(2.058)+(5.016), (I-749)+(2.058)+(5.017), (I-749)+(2.058)+(5.018), (I-749)+(2.058)+(5.019), (I-749)+(2.058)+(5.020), (I-749)+(2.058)+(5.021), (I-749)+(2.058)+(5.022), (I-749)+(2.058)+(5.023), (I-749)+(2.058)+(6.001), (I-749)+(2.058)+(6.002), (I-749)+(2.058)+(6.003), (I-749)+(2.058)+(6.004), (I-749)+(2.058)+(7.001), (I-749)+(2.058)+(7.002), (I-749)+(2.058)+(7.003), (I-749)+(2.058)+(7.004), (I-749)+(2.058)+(7.005), (I-749)+(2.058)+(7.006), (I-749)+(2.058)+(9.001), (I-749)+(2.058)+(9.002), (I-749)+(2.058)+(9.003), (I-749)+(2.058)+(9.004), (I-749)+(2.058)+(9.005), (I-749)+(2.058)+(9.006), (I-749)+(2.058)+(9.007), (I-749)+(2.058)+(9.008), (I-749)+(2.058)+(9.009), (I-749)+(2.058)+(14.001), (I-749)+(2.058)+(14.002), (I-749)+(2.058)+(15.008), (I-749)+(2.058)+(15.011), (I-749)+(2.058)+(15.012), (I-749)+(2.058)+(15.016), (I-749)+(2.058)+(15.025), (I-749)+(2.058)+(15.027), (I-749)+(2.058)+(15.047), (I-749)+(2.058)+(15.063), (I-749)+(2.058)+(15.064), (I-749)+(2.058)+(16.001), (I-749)+(2.058)+(16.002), (I-749)+(2.058)+(16.003), (I-749)+(2.058)+(16.004), (I-749)+(2.058)+(16.005), (I-749)+(2.058)+(16.006), (I-749)+(2.058)+(16.007), (I-749)+(2.058)+(16.008), (I-749)+(2.058)+(17.001), (I-749)+(2.058)+(17.002), (I-749)+(2.058)+(17.003), (I-749)+(2.058)+(17.004), (I-749)+(2.058)+(17.005), (I-749)+(2.058)+(17.006), (I-749)+(2.058)+(17.007), (I-749)+(2.058)+(17.008), (I-749)+(2.058)+(17.009), (I-749)+(2.058)+(17.010), (I-749)+(2.058)+(17.011), (I-749)+(2.058)+(17.012), (I-749)+(2.058)+(18.001),

(I-749)+(2.059)+(3.001), (I-749)+(2.059)+(3.002), (I-749)+(2.059)+(3.003), (I-749)+(2.059)+(3.004), (I-749)+(2.059)+(3.005), (I-749)+(2.059)+(3.006), (I-749)+(2.059)+(3.007), (I-749)+(2.059)+(3.008), (I-749)+(2.059)+(3.009), (I-749)+(2.059)+(3.010), (I-749)+(2.059)+(3.011), (I-749)+(2.059)+(3.012), (I-749)+(2.059)+(3.013), (I-749)+(2.059)+(3.014), (I-749)+(2.059)+(3.015), (I-749)+(2.059)+(3.016), (I-749)+(2.059)+(3.017), (I-749)+(2.059)+(3.018), (I-749)+(2.059)+(3.019), (I-749)+(2.059)+(3.020), (I-749)+(2.059)+(3.021), (I-749)+(2.059)+(3.022), (I-749)+(2.059)+(3.023), (I-749)+(2.059)+(3.024), (I-749)+(2.059)+(3.025), (I-749)+(2.059)+(3.026), (I-749)+(2.059)+(3.027), (I-749)+(2.059)+(3.028), (I-749)+(2.059)+(3.029), (I-749)+(2.059)+(3.030), (I-749)+(2.059)+(3.031), (I-749)+(2.059)+(5.001), (I-749)+(2.059)+(5.002), (I-749)+(2.059)+(5.003), (I-749)+(2.059)+(5.004), (I-749)+(2.059)+(5.005), (I-749)+(2.059)+(5.006), (I-749)+(2.059)+(5.007), (I-749)+(2.059)+(5.008), (I-749)+(2.059)+(5.009), (I-749)+(2.059)+(5.010), (I-749)+(2.059)+(5.011), (I-749)+(2.059)+(5.012), (I-749)+(2.059)+(5.013), (I-749)+(2.059)+(5.014), (I-749)+(2.059)+(5.015), (I-749)+(2.059)+(5.016), (I-749)+(2.059)+(5.017), (I-749)+(2.059)+(5.018), (I-749)+(2.059)+(5.019), (I-749)+(2.059)+(5.020), (I-749)+(2.059)+(5.021), (I-749)+(2.059)+(5.022), (I-749)+(2.059)+(5.023), (I-749)+(2.059)+(6.001), (I-749)+(2.059)+(6.002), (I-749)+(2.059)+(6.003), (I-749)+(2.059)+(6.004), (I-749)+(2.059)+(7.001), (I-749)+(2.059)+(7.002), (I-749)+(2.059)+(7.003), (I-749)+(2.059)+(7.004), (I-749)+(2.059)+(7.005), (I-749)+(2.059)+(7.006), (I-749)+(2.059)+(9.001), (I-749)+(2.059)+(9.002), (I-749)+(2.059)+(9.003), (I-749)+(2.059)+(9.004), (I-749)+(2.059)+(9.005), (I-749)+(2.059)+(9.006), (I-749)+(2.059)+(9.007), (I-749)+(2.059)+(9.008), (I-749)+(2.059)+(9.009), (I-749)+(2.059)+(14.001), (I-749)+(2.059)+(14.002), (I-749)+(2.059)+(15.008), (I-749)+(2.059)+(15.011), (I-749)+(2.059)+(15.012), (I-749)+(2.059)+(15.016), (I-749)+(2.059)+(15.025), (I-749)+(2.059)+(15.027), (I-749)+(2.059)+(15.047), (I-749)+(2.059)+(15.063), (I-749)+(2.059)+(15.064), (I-749)+(2.059)+(16.001), (I-749)+(2.059)+(16.002), (I-749)+(2.059)+(16.003), (I-749)+(2.059)+(16.004), (I-749)+(2.059)+(16.005), (I-749)+(2.059)+(16.006), (I-749)+(2.059)+(16.007), (I-749)+(2.059)+(16.008), (I-749)+(2.059)+(17.001), (I-749)+(2.059)+(17.002), (I-749)+(2.059)+(17.003), (I-749)+(2.059)+(17.004), (I-749)+(2.059)+(17.005), (I-749)+(2.059)+(17.006), (I-749)+(2.059)+(17.007), (I-749)+(2.059)+(17.008), (I-749)+(2.059)+(17.009), (I-749)+(2.059)+(17.010), (I-749)+(2.059)+(17.011), (I-749)+(2.059)+(17.012), (I-749)+(2.059)+(18.001),

(I-749)+(3.001)+(3.025), (I-749)+(3.001)+(3.030), (I-749)+(3.001)+(3.031), (I-749)+(3.001)+(5.001), (I-749)+(3.001)+(5.002), (I-749)+(3.001)+(5.003), (I-749)+(3.001)+(5.004), (I-749)+(3.001)+(5.005), (I-749)+(3.001)+(5.006), (I-749)+(3.001)+(5.007), (I-749)+(3.001)+(5.008), (I-749)+(3.001)+(5.009), (I-749)+(3.001)+(5.010), (I-749)+(3.001)+(5.011), (I-749)+(3.001)+(5.012), (I-749)+(3.001)+(5.013), (I-749)+(3.001)+(5.014), (I-749)+(3.001)+(5.015), (I-749)+(3.001)+(5.016), (I-749)+(3.001)+(5.017), (I-749)+(3.001)+(5.018), (I-749)+(3.001)+(5.019), (I-749)+(3.001)+(5.020), (I-749)+(3.001)+(5.021), (I-749)+(3.001)+(5.022), (I-749)+(3.001)+(5.023), (I-749)+(3.001)+(6.001), (I-749)+(3.001)+(6.002), (I-749)+(3.001)+(6.003), (I-749)+(3.001)+(6.004), (I-749)+(3.001)+(7.001), (I-749)+(3.001)+(7.002), (I-749)+(3.001)+(7.003), (I-749)+(3.001)+(7.004), (I-749)+(3.001)+(7.005), (I-749)+(3.001)+(7.006), (I-749)+(3.001)+(9.001), (I-749)+(3.001)+(9.002), (I-749)+(3.001)+(9.003), (I-749)+(3.001)+(9.004), (I-749)+(3.001)+(9.005), (I-749)+(3.001)+(9.006), (I-749)+(3.001)+(9.007), (I-749)+(3.001)+(9.008), (I-749)+(3.001)+(9.009), (I-749)+(3.001)+(14.001), (I-749)+(3.001)+(14.002), (I-749)+(3.001)+(15.008), (I-749)+(3.001)+(15.011), (I-749)+(3.001)+(15.012), (I-749)+(3.001)+(15.016), (I-749)+(3.001)+(15.025), (I-749)+(3.001)+(15.027), (I-749)+(3.001)+(15.047), (I-749)+(3.001)+(15.063), (I-749)+(3.001)+(15.064), (I-749)+(3.001)+(16.001), (I-749)+(3.001)+(16.002), (I-749)+(3.001)+(16.003), (I-749)+(3.001)+(16.004), (I-749)+(3.001)+(16.005), (I-749)+(3.001)+(16.006), (I-749)+(3.001)+(16.007), (I-749)+(3.001)+(16.008), (I-749)+(3.001)+(17.001), (I-749)+(3.001)+(17.002), (I-749)+(3.001)+(17.003), (I-749)+(3.001)+(17.004), (I-749)+(3.001)+(17.005), (I-749)+(3.001)+(17.006), (I-749)+(3.001)+(17.007), (I-749)+(3.001)+(17.008), (I-749)+(3.001)+(17.009), (I-749)+(3.001)+(17.010), (I-749)+(3.001)+(17.011), (I-749)+(3.001)+(17.012), (I-749)+(3.001)+(18.001),

(I-749)+(3.002)+(3.025), (I-749)+(3.002)+(3.030), (I-749)+(3.002)+(3.031), (I-749)+(3.002)+(5.001), (I-749)+(3.002)+(5.002), (I-749)+(3.002)+(5.003), (I-749)+(3.002)+(5.004), (I-749)+(3.002)+(5.005), (I-749)+(3.002)+(5.006), (I-749)+(3.002)+(5.007), (I-749)+(3.002)+(5.008), (I-749)+(3.002)+(5.009), (I-749)+(3.002)+(5.010), (I-749)+(3.002)+(5.011), (I-749)+(3.002)+(5.012), (I-749)+(3.002)+(5.013), (I-749)+(3.002)+(5.014), (I-749)+(3.002)+(5.015), (I-749)+(3.002)+(5.016), (I-749)+(3.002)+(5.017), (I-749)+(3.002)+(5.018), (I-749)+(3.002)+(5.019), (I-749)+(3.002)+(5.020), (I-749)+(3.002)+(5.021), (I-749)+(3.002)+(5.022), (I-749)+(3.002)+(5.023), (I-749)+(3.002)+(6.001), (I-749)+(3.002)+(6.002), (I-749)+(3.002)+(6.003), (I-749)+(3.002)+(6.004), (I-749)+(3.002)+(7.001), (I-749)+(3.002)+(7.002), (I-749)+(3.002)+(7.003), (I-749)+(3.002)+(7.004), (I-749)+(3.002)+(7.005), (I-749)+(3.002)+(7.006), (I-749)+(3.002)+(9.001), (I-749)+(3.002)+(9.002), (I-749)+(3.002)+(9.003), (I-749)+(3.002)+(9.004), (I-749)+(3.002)+(9.005), (I-749)+(3.002)+(9.006), (I-749)+(3.002)+(9.007), (I-749)+(3.002)+(9.008), (I-749)+(3.002)+(9.009), (I-749)+(3.002)+(14.001), (I-749)+(3.002)+(14.002), (I-749)+(3.002)+(15.008), (I-749)+(3.002)+(15.011), (I-749)+(3.002)+(15.012), (I-749)+(3.002)+(15.016), (I-749)+(3.002)+(15.025), (I-749)+(3.002)+(15.027), (I-749)+(3.002)+(15.047), (I-749)+(3.002)+(15.063), (I-749)+(3.002)+(15.064), (I-749)+(3.002)+(16.001), (I-749)+(3.002)+(16.002), (I-749)+(3.002)+(16.003), (I-749)+(3.002)+(16.004), (I-749)+(3.002)+(16.005), (I-749)+(3.002)+(16.006), (I-749)+(3.002)+(16.007), (I-749)+(3.002)+(16.008), (I-749)+(3.002)+(17.001), (I-749)+(3.002)+(17.002), (I-749)+(3.002)+(17.003), (I-749)+(3.002)+(17.004), (I-749)+(3.002)+(17.005), (I-749)+(3.002)+(17.006), (I-749)+(3.002)+(17.007), (I-749)+(3.002)+(17.008), (I-749)+(3.002)+(17.009), (I-749)+(3.002)+(17.010), (I-749)+(3.002)+(17.011), (I-749)+(3.002)+(17.012), (I-749)+(3.002)+(18.001),

(I-749)+(3.003)+(3.025), (I-749)+(3.003)+(3.030), (I-749)+(3.003)+(3.031), (I-749)+(3.003)+(5.001), (I-749)+(3.003)+(5.002), (I-749)+(3.003)+(5.003), (I-749)+(3.003)+(5.004), (I-749)+(3.003)+(5.005), (I-749)+(3.003)+(5.006), (I-749)+(3.003)+(5.007), (I-749)+(3.003)+(5.008), (I-749)+(3.003)+(5.009), (I-749)+(3.003)+(5.010), (I-749)+(3.003)+(5.011), (I-749)+(3.003)+(5.012), (I-749)+(3.003)+(5.013), (I-749)+(3.003)+(5.014), (I-749)+(3.003)+(5.015), (I-749)+(3.003)+(5.016), (I-749)+(3.003)+(5.017), (I-749)+(3.003)+(5.018), (I-749)+(3.003)+(5.019), (I-749)+(3.003)+(5.020), (I-749)+(3.003)+(5.021), (I-749)+(3.003)+(5.022), (I-749)+(3.003)+(5.023), (I-749)+(3.003)+(6.001), (I-749)+(3.003)+(6.002), (I-749)+(3.003)+(6.003), (I-749)+(3.003)+(6.004), (I-749)+(3.003)+(7.001), (I-749)+(3.003)+(7.002), (I-749)+(3.003)+(7.003), (I-749)+(3.003)+(7.004), (I-749)+(3.003)+(7.005), (I-749)+(3.003)+(7.006), (I-749)+(3.003)+(9.001), (I-749)+(3.003)+(9.002), (I-749)+(3.003)+(9.003), (I-749)+(3.003)+(9.004), (I-749)+(3.003)+(9.005), (I-749)+(3.003)+(9.006), (I-749)+(3.003)+(9.007), (I-749)+(3.003)+(9.008), (I-749)+(3.003)+(9.009), (I-749)+(3.003)+(14.001), (I-749)+(3.003)+(14.002), (I-749)+(3.003)+(15.008), (I-749)+(3.003)+(15.011), (I-749)+(3.003)+(15.012), (I-749)+(3.003)+(15.016), (I-749)+(3.003)+(15.025), (I-749)+(3.003)+(15.027), (I-749)+(3.003)+(15.047), (I-749)+(3.003)+(15.063), (I-749)+(3.003)+(15.064), (I-749)+(3.003)+(16.001), (I-749)+(3.003)+(16.002), (I-749)+(3.003)+(16.003), (I-749)+(3.003)+(16.004), (I-749)+(3.003)+(16.005), (I-749)+(3.003)+(16.006), (I-749)+(3.003)+(16.007), (I-749)+(3.003)+(16.008), (I-749)+(3.003)+(17.001), (I-749)+(3.003)+(17.002), (I-749)+(3.003)+(17.003), (I-749)+(3.003)+(17.004), (I-749)+(3.003)+(17.005), (I-749)+(3.003)+(17.006), (I-749)+(3.003)+(17.007), (I-749)+(3.003)+(17.008), (I-749)+(3.003)+(17.009), (I-749)+(3.003)+(17.010), (I-749)+(3.003)+(17.011), (I-749)+(3.003)+(17.012), (I-749)+(3.003)+(18.001),

(I-749)+(3.004)+(3.025), (I-749)+(3.004)+(3.030), (I-749)+(3.004)+(3.031), (I-749)+(3.004)+(5.001), (I-749)+(3.004)+(5.002), (I-749)+(3.004)+(5.003), (I-749)+(3.004)+(5.004), (I-749)+(3.004)+(5.005), (I-749)+(3.004)+(5.006), (I-749)+(3.004)+(5.007), (I-749)+(3.004)+(5.008), (I-749)+(3.004)+(5.009), (I-749)+(3.004)+(5.010), (I-749)+(3.004)+(5.011), (I-749)+(3.004)+(5.012), (I-749)+(3.004)+(5.013), (I-749)+(3.004)+(5.014), (I-749)+(3.004)+(5.015), (I-749)+(3.004)+(5.016), (I-749)+(3.004)+(5.017), (I-749)+(3.004)+(5.018), (I-749)+(3.004)+(5.019), (I-749)+(3.004)+(5.020), (I-749)+(3.004)+(5.021), (I-749)+(3.004)+(5.022), (I-749)+(3.004)+(5.023), (I-749)+(3.004)+(6.001), (I-749)+(3.004)+(6.002), (I-749)+(3.004)+(6.003), (I-749)+(3.004)+(6.004), (I-749)+(3.004)+(7.001), (I-749)+(3.004)+(7.002), (I-749)+(3.004)+(7.003), (I-749)+(3.004)+(7.004), (I-749)+(3.004)+(7.005), (I-749)+(3.004)+(7.006), (I-749)+(3.004)+(9.001), (I-749)+(3.004)+(9.002), (I-749)+(3.004)+(9.003), (I-749)+(3.004)+(9.004), (I-749)+(3.004)+(9.005), (I-749)+(3.004)+(9.006), (I-749)+(3.004)+(9.007), (I-749)+(3.004)+(9.008), (I-749)+(3.004)+(9.009), (I-749)+(3.004)+(14.001), (I-749)+(3.004)+(14.002), (I-749)+(3.004)+(15.008), (I-749)+(3.004)+(15.011), (I-749)+(3.004)+(15.012), (I-749)+(3.004)+(15.016), (I-749)+(3.004)+(15.025), (I-749)+(3.004)+(15.027), (I-749)+(3.004)+(15.047), (I-749)+(3.004)+(15.063), (I-749)+(3.004)+(15.064), (I-749)+(3.004)+(16.001), (I-749)+(3.004)+(16.002), (I-749)+(3.004)+(16.003), (I-749)+(3.004)+(16.004), (I-749)+(3.004)+(16.005), (I-749)+(3.004)+(16.006), (I-749)+(3.004)+(16.007), (I-749)+(3.004)+(16.008), (I-749)+(3.004)+(17.001), (I-749)+(3.004)+(17.002), (I-749)+(3.004)+(17.003), (I-749)+(3.004)+(17.004), (I-749)+(3.004)+(17.005), (I-749)+(3.004)+(17.006), (I-749)+(3.004)+(17.007), (I-749)+(3.004)+(17.008), (I-749)+(3.004)+(17.009), (I-749)+(3.004)+(17.010), (I-749)+(3.004)+(17.011), (I-749)+(3.004)+(17.012), (I-749)+(3.004)+(18.001),

(I-749)+(3.005)+(3.025), (I-749)+(3.005)+(3.030), (I-749)+(3.005)+(3.031), (I-749)+(3.005)+(5.001), (I-749)+(3.005)+(5.002), (I-749)+(3.005)+(5.003), (I-749)+(3.005)+(5.004), (I-749)+(3.005)+(5.005), (I-749)+(3.005)+(5.006), (I-749)+(3.005)+(5.007), (I-749)+(3.005)+(5.008), (I-749)+(3.005)+(5.009), (I-749)+(3.005)+(5.010), (I-749)+(3.005)+(5.011), (I-749)+(3.005)+(5.012), (I-749)+(3.005)+(5.013), (I-749)+(3.005)+(5.014), (I-749)+(3.005)+(5.015), (I-749)+(3.005)+(5.016), (I-749)+(3.005)+(5.017), (I-749)+(3.005)+(5.018), (I-749)+(3.005)+(5.019), (I-749)+(3.005)+(5.020), (I-749)+(3.005)+(5.021), (I-749)+(3.005)+(5.022), (I-749)+(3.005)+(5.023), (I-749)+(3.005)+(6.001), (I-749)+(3.005)+(6.002), (I-749)+(3.005)+(6.003), (I-749)+(3.005)+(6.004), (I-749)+(3.005)+(7.001), (I-749)+(3.005)+(7.002), (I-749)+(3.005)+(7.003), (I-749)+(3.005)+(7.004), (I-749)+(3.005)+(7.005), (I-749)+(3.005)+(7.006), (I-749)+(3.005)+(9.001), (I-749)+(3.005)+(9.002), (I-749)+(3.005)+(9.003), (I-749)+(3.005)+(9.004), (I-749)+(3.005)+(9.005), (I-749)+(3.005)+(9.006), (I-749)+(3.005)+(9.007), (I-749)+(3.005)+(9.008), (I-749)+(3.005)+(9.009), (I-749)+(3.005)+(14.001), (I-749)+(3.005)+(14.002), (I-749)+(3.005)+(15.008), (I-749)+(3.005)+(15.011), (I-749)+(3.005)+(15.012), (I-749)+(3.005)+(15.016), (I-749)+(3.005)+(15.025), (I-749)+(3.005)+(15.027), (I-749)+(3.005)+(15.047), (I-749)+(3.005)+(15.063), (I-749)+(3.005)+(15.064), (I-749)+(3.005)+(16.001), (I-749)+(3.005)+(16.002), (I-749)+(3.005)+(16.003), (I-749)+(3.005)+(16.004), (I-749)+(3.005)+(16.005), (I-749)+(3.005)+(16.006), (I-749)+(3.005)+(16.007), (I-749)+(3.005)+(16.008), (I-749)+(3.005)+(17.001), (I-749)+(3.005)+(17.002), (I-749)+(3.005)+(17.003), (I-749)+(3.005)+(17.004), (I-749)+(3.005)+(17.005), (I-749)+(3.005)+(17.006), (I-749)+(3.005)+(17.007), (I-749)+(3.005)+(17.008), (I-749)+(3.005)+(17.009), (I-749)+(3.005)+(17.010), (I-749)+(3.005)+(17.011), (I-749)+(3.005)+(17.012), (I-749)+(3.005)+(18.001),

(I-749)+(3.006)+(3.025), (I-749)+(3.006)+(3.030), (I-749)+(3.006)+(3.031), (I-749)+(3.006)+(5.001), (I-749)+(3.006)+(5.002), (I-749)+(3.006)+(5.003), (I-749)+(3.006)+(5.004), (I-749)+(3.006)+(5.005), (I-749)+(3.006)+(5.006), (I-749)+(3.006)+(5.007), (I-749)+(3.006)+(5.008), (I-749)+(3.006)+(5.009), (I-749)+(3.006)+(5.010), (I-749)+(3.006)+(5.011), (I-749)+(3.006)+(5.012), (I-749)+(3.006)+(5.013), (I-749)+(3.006)+(5.014), (I-749)+(3.006)+(5.015), (I-749)+(3.006)+(5.016), (I-749)+(3.006)+(5.017), (I-749)+(3.006)+(5.018), (I-749)+(3.006)+(5.019), (I-749)+(3.006)+(5.020), (I-749)+(3.006)+(5.021), (I-749)+(3.006)+(5.022), (I-749)+(3.006)+(5.023), (I-749)+(3.006)+(6.001), (I-749)+(3.006)+(6.002), (I-749)+(3.006)+(6.003), (I-749)+(3.006)+(6.004), (I-749)+(3.006)+(7.001), (I-749)+(3.006)+(7.002), (I-749)+(3.006)+(7.003), (I-749)+(3.006)+(7.004), (I-749)+(3.006)+(7.005), (I-749)+(3.006)+(7.006), (I-749)+(3.006)+(9.001), (I-749)+(3.006)+(9.002), (I-749)+(3.006)+(9.003), (I-749)+(3.006)+(9.004), (I-749)+(3.006)+(9.005), (I-749)+(3.006)+(9.006), (I-749)+(3.006)+(9.007), (I-749)+(3.006)+(9.008), (I-749)+(3.006)+(9.009), (I-749)+(3.006)+(14.001), (I-749)+(3.006)+(14.002), (I-749)+(3.006)+(15.008), (I-749)+(3.006)+(15.011), (I-749)+(3.006)+(15.012), (I-749)+(3.006)+(15.016), (I-749)+(3.006)+(15.025), (I-749)+(3.006)+(15.027), (I-749)+(3.006)+(15.047), (I-749)+(3.006)+(15.063), (I-749)+(3.006)+(15.064), (I-749)+(3.006)+(16.001), (I-749)+(3.006)+(16.002), (I-749)+(3.006)+(16.003), (I-749)+(3.006)+(16.004), (I-749)+(3.006)+(16.005), (I-749)+(3.006)+(16.006), (I-749)+(3.006)+(16.007), (I-749)+(3.006)+(16.008), (I-749)+(3.006)+(17.001), (I-749)+(3.006)+(17.002), (I-749)+(3.006)+(17.003), (I-749)+(3.006)+(17.004), (I-749)+(3.006)+(17.005), (I-749)+(3.006)+(17.006), (I-749)+(3.006)+(17.007), (I-749)+(3.006)+(17.008), (I-749)+(3.006)+(17.009), (I-749)+(3.006)+(17.010), (I-749)+(3.006)+(17.011), (I-749)+(3.006)+(17.012), (I-749)+(3.006)+(18.001),

(I-749)+(3.007)+(3.025), (I-749)+(3.007)+(3.030), (I-749)+(3.007)+(3.031), (I-749)+(3.007)+(5.001), (I-749)+(3.007)+(5.002), (I-749)+(3.007)+(5.003), (I-749)+(3.007)+(5.004), (I-749)+(3.007)+(5.005), (I-749)+(3.007)+(5.006), (I-749)+(3.007)+(5.007), (I-749)+(3.007)+(5.008), (I-749)+(3.007)+(5.009), (I-749)+(3.007)+(5.010), (I-749)+(3.007)+(5.011), (I-749)+(3.007)+(5.012), (I-749)+(3.007)+(5.013), (I-749)+(3.007)+(5.014), (I-749)+(3.007)+(5.015), (I-749)+(3.007)+(5.016), (I-749)+(3.007)+(5.017), (I-749)+(3.007)+(5.018), (I-749)+(3.007)+(5.019), (I-749)+(3.007)+(5.020), (I-749)+(3.007)+(5.021), (I-749)+(3.007)+(5.022), (I-749)+(3.007)+(5.023), (I-749)+(3.007)+(6.001), (I-749)+(3.007)+(6.002), (I-749)+(3.007)+(6.003), (I-749)+(3.007)+(6.004), (I-749)+(3.007)+(7.001), (I-749)+(3.007)+(7.002), (I-749)+(3.007)+(7.003), (I-749)+(3.007)+(7.004), (I-749)+(3.007)+(7.005), (I-749)+(3.007)+(7.006), (I-749)+(3.007)+(9.001), (I-749)+(3.007)+(9.002), (I-749)+(3.007)+(9.003), (I-749)+(3.007)+(9.004), (I-749)+(3.007)+(9.005), (I-749)+(3.007)+(9.006), (I-749)+(3.007)+(9.007), (I-749)+(3.007)+(9.008), (I-749)+(3.007)+(9.009), (I-749)+(3.007)+(14.001), (I-749)+(3.007)+(14.002), (I-749)+(3.007)+(15.008), (I-749)+(3.007)+(15.011), (I-749)+(3.007)+(15.012), (I-749)+(3.007)+(15.016), (I-749)+(3.007)+(15.025), (I-749)+(3.007)+(15.027), (I-749)+(3.007)+(15.047), (I-749)+(3.007)+(15.063), (I-749)+(3.007)+(15.064), (I-749)+(3.007)+(16.001), (I-749)+(3.007)+(16.002), (I-749)+(3.007)+(16.003), (I-749)+(3.007)+(16.004), (I-749)+(3.007)+(16.005), (I-749)+(3.007)+(16.006), (I-749)+(3.007)+(16.007), (I-749)+(3.007)+(16.008), (I-749)+(3.007)+(17.001), (I-749)+(3.007)+(17.002), (I-749)+(3.007)+(17.003), (I-749)+(3.007)+(17.004), (I-749)+(3.007)+(17.005), (I-749)+(3.007)+(17.006), (I-749)+(3.007)+(17.007), (I-749)+(3.007)+(17.008), (I-749)+(3.007)+(17.009), (I-749)+(3.007)+(17.010), (I-749)+(3.007)+(17.011), (I-749)+(3.007)+(17.012), (I-749)+(3.007)+(18.001),

(I-749)+(3.008)+(3.025), (I-749)+(3.008)+(3.030), (I-749)+(3.008)+(3.031), (I-749)+(3.008)+(5.001), (I-749)+(3.008)+(5.002), (I-749)+(3.008)+(5.003), (I-749)+(3.008)+(5.004), (I-749)+(3.008)+(5.005), (I-749)+(3.008)+(5.006), (I-749)+(3.008)+(5.007), (I-749)+(3.008)+(5.008), (I-749)+(3.008)+(5.009), (I-749)+(3.008)+(5.010), (I-749)+(3.008)+(5.011), (I-749)+(3.008)+(5.012), (I-749)+(3.008)+(5.013), (I-749)+(3.008)+(5.014), (I-749)+(3.008)+(5.015), (I-749)+(3.008)+(5.016), (I-749)+(3.008)+(5.017), (I-749)+(3.008)+(5.018), (I-749)+(3.008)+(5.019), (I-749)+(3.008)+(5.020), (I-749)+(3.008)+(5.021), (I-749)+(3.008)+(5.022), (I-749)+(3.008)+(5.023), (I-749)+(3.008)+(6.001), (I-749)+(3.008)+(6.002), (I-749)+(3.008)+(6.003), (I-749)+(3.008)+(6.004), (I-749)+(3.008)+(7.001), (I-749)+(3.008)+(7.002), (I-749)+(3.008)+(7.003), (I-749)+(3.008)+(7.004), (I-749)+(3.008)+(7.005), (I-749)+(3.008)+(7.006), (I-749)+(3.008)+(9.001), (I-749)+(3.008)+(9.002), (I-749)+(3.008)+(9.003), (I-749)+(3.008)+(9.004), (I-749)+(3.008)+(9.005), (I-749)+(3.008)+(9.006), (I-749)+(3.008)+(9.007), (I-749)+(3.008)+(9.008), (I-749)+(3.008)+(9.009), (I-749)+(3.008)+(14.001), (I-749)+(3.008)+(14.002), (I-749)+(3.008)+(15.008), (I-749)+(3.008)+(15.011), (I-749)+(3.008)+(15.012), (I-749)+(3.008)+(15.016), (I-749)+(3.008)+(15.025), (I-749)+(3.008)+(15.027), (I-749)+(3.008)+(15.047), (I-749)+(3.008)+(15.063), (I-749)+(3.008)+(15.064), (I-749)+(3.008)+(16.001), (I-749)+(3.008)+(16.002), (I-749)+(3.008)+(16.003), (I-749)+(3.008)+(16.004), (I-749)+(3.008)+(16.005), (I-749)+(3.008)+(16.006), (I-749)+(3.008)+(16.007), (I-749)+(3.008)+(16.008), (I-749)+(3.008)+(17.001), (I-749)+(3.008)+(17.002), (I-749)+(3.008)+(17.003), (I-749)+(3.008)+(17.004), (I-749)+(3.008)+(17.005), (I-749)+(3.008)+(17.006), (I-749)+(3.008)+(17.007), (I-749)+(3.008)+(17.008), (I-749)+(3.008)+(17.009), (I-749)+(3.008)+(17.010), (I-749)+(3.008)+(17.011), (I-749)+(3.008)+(17.012), (I-749)+(3.008)+(18.001),

(I-749)+(3.009)+(3.025), (I-749)+(3.009)+(3.030), (I-749)+(3.009)+(3.031), (I-749)+(3.009)+(5.001), (I-749)+(3.009)+(5.002), (I-749)+(3.009)+(5.003), (I-749)+(3.009)+(5.004), (I-749)+(3.009)+(5.005), (I-749)+(3.009)+(5.006), (I-749)+(3.009)+(5.007), (I-749)+(3.009)+(5.008), (I-749)+(3.009)+(5.009), (I-749)+(3.009)+(5.010), (I-749)+(3.009)+(5.011), (I-749)+(3.009)+(5.012), (I-749)+(3.009)+(5.013), (I-749)+(3.009)+(5.014), (I-749)+(3.009)+(5.015), (I-749)+(3.009)+(5.016), (I-749)+(3.009)+(5.017), (I-749)+(3.009)+(5.018), (I-749)+(3.009)+(5.019), (I-749)+(3.009)+(5.020), (I-749)+(3.009)+(5.021), (I-749)+(3.009)+(5.022), (I-749)+(3.009)+(5.023), (I-749)+(3.009)+(6.001), (I-749)+(3.009)+(6.002), (I-749)+(3.009)+(6.003), (I-749)+(3.009)+(6.004), (I-749)+(3.009)+(7.001), (I-749)+(3.009)+(7.002), (I-749)+(3.009)+(7.003), (I-749)+(3.009)+(7.004), (I-749)+(3.009)+(7.005), (I-749)+(3.009)+(7.006), (I-749)+(3.009)+(9.001), (I-749)+(3.009)+(9.002), (I-749)+(3.009)+(9.003), (I-749)+(3.009)+(9.004), (I-749)+(3.009)+(9.005), (I-749)+(3.009)+(9.006), (I-749)+(3.009)+(9.007), (I-749)+(3.009)+(9.008), (I-749)+(3.009)+(9.009), (I-749)+(3.009)+(14.001), (I-749)+(3.009)+(14.002), (I-749)+(3.009)+(15.008), (I-749)+(3.009)+(15.011), (I-749)+(3.009)+(15.012), (I-749)+(3.009)+(15.016), (I-749)+(3.009)+(15.025), (I-749)+(3.009)+(15.027), (I-749)+(3.009)+(15.047), (I-749)+(3.009)+(15.063), (I-749)+(3.009)+(15.064), (I-749)+(3.009)+(16.001), (I-749)+(3.009)+(16.002), (I-749)+(3.009)+(16.003), (I-749)+(3.009)+(16.004), (I-749)+(3.009)+(16.005), (I-749)+(3.009)+(16.006), (I-749)+(3.009)+(16.007), (I-749)+(3.009)+(16.008), (I-749)+(3.009)+(17.001), (I-749)+(3.009)+(17.002), (I-749)+(3.009)+(17.003), (I-749)+(3.009)+(17.004), (I-749)+(3.009)+(17.005), (I-749)+(3.009)+(17.006), (I-749)+(3.009)+(17.007), (I-749)+(3.009)+(17.008), (I-749)+(3.009)+(17.009), (I-749)+(3.009)+(17.010), (I-749)+(3.009)+(17.011), (I-749)+(3.009)+(17.012), (I-749)+(3.009)+(18.001),

(I-749)+(3.010)+(3.025), (I-749)+(3.010)+(3.030), (I-749)+(3.010)+(3.031), (I-749)+(3.010)+(5.001), (I-749)+(3.010)+(5.002), (I-749)+(3.010)+(5.003), (I-749)+(3.010)+(5.004), (I-749)+(3.010)+(5.005), (I-749)+(3.010)+(5.006), (I-749)+(3.010)+(5.007), (I-749)+(3.010)+(5.008), (I-749)+(3.010)+(5.009), (I-749)+(3.010)+(5.010), (I-749)+(3.010)+(5.011), (I-749)+(3.010)+(5.012), (I-749)+(3.010)+(5.013), (I-749)+(3.010)+(5.014), (I-749)+(3.010)+(5.015), (I-749)+(3.010)+(5.016), (I-749)+(3.010)+(5.017), (I-749)+(3.010)+(5.018), (I-749)+(3.010)+(5.019), (I-749)+(3.010)+(5.020), (I-749)+(3.010)+(5.021), (I-749)+(3.010)+(5.022), (I-749)+(3.010)+(5.023), (I-749)+(3.010)+(6.001), (I-749)+(3.010)+(6.002), (I-749)+(3.010)+(6.003), (I-749)+(3.010)+(6.004), (I-749)+(3.010)+(7.001), (I-749)+(3.010)+(7.002), (I-749)+(3.010)+(7.003), (I-749)+(3.010)+(7.004), (I-749)+(3.010)+(7.005), (I-749)+(3.010)+(7.006), (I-749)+(3.010)+(9.001), (I-749)+(3.010)+(9.002), (I-749)+(3.010)+(9.003), (I-749)+(3.010)+(9.004), (I-749)+(3.010)+(9.005), (I-749)+(3.010)+(9.006), (I-749)+(3.010)+(9.007), (I-749)+(3.010)+(9.008), (I-749)+(3.010)+(9.009), (I-749)+(3.010)+(14.001), (I-749)+(3.010)+(14.002), (I-749)+(3.010)+(15.008), (I-749)+(3.010)+(15.011), (I-749)+(3.010)+(15.012), (I-749)+(3.010)+(15.016), (I-749)+(3.010)+(15.025), (I-749)+(3.010)+(15.027), (I-749)+(3.010)+(15.047), (I-749)+(3.010)+(15.063), (I-749)+(3.010)+(15.064), (I-749)+(3.010)+(16.001), (I-749)+(3.010)+(16.002), (I-749)+(3.010)+(16.003), (I-749)+(3.010)+(16.004), (I-749)+(3.010)+(16.005), (I-749)+(3.010)+(16.006), (I-749)+(3.010)+(16.007), (I-749)+(3.010)+(16.008), (I-749)+(3.010)+(17.001), (I-749)+(3.010)+(17.002), (I-749)+(3.010)+(17.003), (I-749)+(3.010)+(17.004), (I-749)+(3.010)+(17.005), (I-749)+(3.010)+(17.006), (I-749)+(3.010)+(17.007), (I-749)+(3.010)+(17.008), (I-749)+(3.010)+(17.009), (I-749)+(3.010)+(17.010), (I-749)+(3.010)+(17.011), (I-749)+(3.010)+(17.012), (I-749)+(3.010)+(18.001),

(I-749)+(3.011)+(3.025), (I-749)+(3.011)+(3.030), (I-749)+(3.011)+(3.031), (I-749)+(3.011)+(5.001), (I-749)+(3.011)+(5.002), (I-749)+(3.011)+(5.003), (I-749)+(3.011)+(5.004), (I-749)+(3.011)+(5.005), (I-749)+(3.011)+(5.006), (I-749)+(3.011)+(5.007), (I-749)+(3.011)+(5.008), (I-749)+(3.011)+(5.009), (I-749)+(3.011)+(5.010), (I-749)+(3.011)+(5.011), (I-749)+(3.011)+(5.012), (I-749)+(3.011)+(5.013), (I-749)+(3.011)+(5.014), (I-749)+(3.011)+(5.015), (I-749)+(3.011)+(5.016), (I-749)+(3.011)+(5.017), (I-749)+(3.011)+(5.018), (I-749)+(3.011)+(5.019), (I-749)+(3.011)+(5.020), (I-749)+(3.011)+(5.021), (I-749)+(3.011)+(5.022), (I-749)+(3.011)+(5.023), (I-749)+(3.011)+(6.001), (I-749)+(3.011)+(6.002), (I-749)+(3.011)+(6.003), (I-749)+(3.011)+(6.004), (I-749)+(3.011)+(7.001), (I-749)+(3.011)+(7.002), (I-749)+(3.011)+(7.003), (I-749)+(3.011)+(7.004), (I-749)+(3.011)+(7.005), (I-749)+(3.011)+(7.006), (I-749)+(3.011)+(9.001), (I-749)+(3.011)+(9.002), (I-749)+(3.011)+(9.003), (I-749)+(3.011)+(9.004), (I-749)+(3.011)+(9.005), (I-749)+(3.011)+(9.006), (I-749)+(3.011)+(9.007), (I-749)+(3.011)+(9.008), (I-749)+(3.011)+(9.009), (I-749)+(3.011)+(14.001), (I-749)+(3.011)+(14.002), (I-749)+(3.011)+(15.008), (I-749)+(3.011)+(15.011), (I-749)+(3.011)+(15.012), (I-749)+(3.011)+(15.016), (I-749)+(3.011)+(15.025), (I-749)+(3.011)+(15.027), (I-749)+(3.011)+(15.047), (I-749)+(3.011)+(15.063), (I-749)+(3.011)+(15.064), (I-749)+(3.011)+(16.001), (I-749)+(3.011)+(16.002), (I-749)+(3.011)+(16.003), (I-749)+(3.011)+(16.004), (I-749)+(3.011)+(16.005), (I-749)+(3.011)+(16.006), (I-749)+(3.011)+(16.007), (I-749)+(3.011)+(16.008), (I-749)+(3.011)+(17.001), (I-749)+(3.011)+(17.002), (I-749)+(3.011)+(17.003), (I-749)+(3.011)+(17.004), (I-749)+(3.011)+(17.005), (I-749)+(3.011)+(17.006), (I-749)+(3.011)+(17.007), (I-749)+(3.011)+(17.008), (I-749)+(3.011)+(17.009), (I-749)+(3.011)+(17.010), (I-749)+(3.011)+(17.011), (I-749)+(3.011)+(17.012), (I-749)+(3.011)+(18.001),

(I-749)+(3.012)+(3.025), (I-749)+(3.012)+(3.030), (I-749)+(3.012)+(3.031), (I-749)+(3.012)+(5.001), (I-749)+(3.012)+(5.002), (I-749)+(3.012)+(5.003), (I-749)+(3.012)+(5.004), (I-749)+(3.012)+(5.005), (I-749)+(3.012)+(5.006), (I-749)+(3.012)+(5.007), (I-749)+(3.012)+(5.008), (I-749)+(3.012)+(5.009), (I-749)+(3.012)+(5.010), (I-749)+(3.012)+(5.011), (I-749)+(3.012)+(5.012), (I-749)+(3.012)+(5.013), (I-749)+(3.012)+(5.014), (I-749)+(3.012)+(5.015), (I-749)+(3.012)+(5.016), (I-749)+(3.012)+(5.017), (I-749)+(3.012)+(5.018), (I-749)+(3.012)+(5.019), (I-749)+(3.012)+(5.020), (I-749)+(3.012)+(5.021), (I-749)+(3.012)+(5.022), (I-749)+(3.012)+(5.023), (I-749)+(3.012)+(6.001), (I-749)+(3.012)+(6.002), (I-749)+(3.012)+(6.003), (I-749)+(3.012)+(6.004), (I-749)+(3.012)+(7.001), (I-749)+(3.012)+(7.002), (I-749)+(3.012)+(7.003), (I-749)+(3.012)+(7.004), (I-749)+(3.012)+(7.005), (I-749)+(3.012)+(7.006), (I-749)+(3.012)+(9.001), (I-749)+(3.012)+(9.002), (I-749)+(3.012)+(9.003), (I-749)+(3.012)+(9.004), (I-749)+(3.012)+(9.005), (I-749)+(3.012)+(9.006), (I-749)+(3.012)+(9.007), (I-749)+(3.012)+(9.008), (I-749)+(3.012)+(9.009), (I-749)+(3.012)+(14.001), (I-749)+(3.012)+(14.002), (I-749)+(3.012)+(15.008), (I-749)+(3.012)+(15.011), (I-749)+(3.012)+(15.012), (I-749)+(3.012)+(15.016), (I-749)+(3.012)+(15.025), (I-749)+(3.012)+(15.027), (I-749)+(3.012)+(15.047), (I-749)+(3.012)+(15.063), (I-749)+(3.012)+(15.064), (I-749)+(3.012)+(16.001), (I-749)+(3.012)+(16.002), (I-749)+(3.012)+(16.003), (I-749)+(3.012)+(16.004), (I-749)+(3.012)+(16.005), (I-749)+(3.012)+(16.006), (I-749)+(3.012)+(16.007), (I-749)+(3.012)+(16.008), (I-749)+(3.012)+(17.001), (I-749)+(3.012)+(17.002), (I-749)+(3.012)+(17.003), (I-749)+(3.012)+(17.004), (I-749)+(3.012)+(17.005), (I-749)+(3.012)+(17.006), (I-749)+(3.012)+(17.007), (I-749)+(3.012)+(17.008), (I-749)+(3.012)+(17.009), (I-749)+(3.012)+(17.010), (I-749)+(3.012)+(17.011), (I-749)+(3.012)+(17.012), (I-749)+(3.012)+(18.001),

(I-749)+(3.013)+(3.025), (I-749)+(3.013)+(3.030), (I-749)+(3.013)+(3.031), (I-749)+(3.013)+(5.001), (I-749)+(3.013)+(5.002), (I-749)+(3.013)+(5.003), (I-749)+(3.013)+(5.004), (I-749)+(3.013)+(5.005), (I-749)+(3.013)+(5.006), (I-749)+(3.013)+(5.007), (I-749)+(3.013)+(5.008), (I-749)+(3.013)+(5.009), (I-749)+(3.013)+(5.010), (I-749)+(3.013)+(5.011), (I-749)+(3.013)+(5.012), (I-749)+(3.013)+(5.013), (I-749)+(3.013)+(5.014), (I-749)+(3.013)+(5.015), (I-749)+(3.013)+(5.016), (I-749)+(3.013)+(5.017), (I-749)+(3.013)+(5.018), (I-749)+(3.013)+(5.019), (I-749)+(3.013)+(5.020), (I-749)+(3.013)+(5.021), (I-749)+(3.013)+(5.022), (I-749)+(3.013)+(5.023), (I-749)+(3.013)+(6.001), (I-749)+(3.013)+(6.002), (I-749)+(3.013)+(6.003), (I-749)+(3.013)+(6.004), (I-749)+(3.013)+(7.001), (I-749)+(3.013)+(7.002), (I-749)+(3.013)+(7.003), (I-749)+(3.013)+(7.004), (I-749)+(3.013)+(7.005), (I-749)+(3.013)+(7.006), (I-749)+(3.013)+(9.001), (I-749)+(3.013)+(9.002), (I-749)+(3.013)+(9.003), (I-749)+(3.013)+(9.004), (I-749)+(3.013)+(9.005), (I-749)+(3.013)+(9.006), (I-749)+(3.013)+(9.007), (I-749)+(3.013)+(9.008), (I-749)+(3.013)+(9.009), (I-749)+(3.013)+(14.001), (I-749)+(3.013)+(14.002), (I-749)+(3.013)+(15.008), (I-749)+(3.013)+(15.011), (I-749)+(3.013)+(15.012), (I-749)+(3.013)+(15.016), (I-749)+(3.013)+(15.025), (I-749)+(3.013)+(15.027), (I-749)+(3.013)+(15.047), (I-749)+(3.013)+(15.063), (I-749)+(3.013)+(15.064), (I-749)+(3.013)+(16.001), (I-749)+(3.013)+(16.002), (I-749)+(3.013)+(16.003), (I-749)+(3.013)+(16.004), (I-749)+(3.013)+(16.005), (I-749)+(3.013)+(16.006), (I-749)+(3.013)+(16.007), (I-749)+(3.013)+(16.008), (I-749)+(3.013)+(17.001), (I-749)+(3.013)+(17.002), (I-749)+(3.013)+(17.003), (I-749)+(3.013)+(17.004), (I-749)+(3.013)+(17.005), (I-749)+(3.013)+(17.006), (I-749)+(3.013)+(17.007), (I-749)+(3.013)+(17.008), (I-749)+(3.013)+(17.009), (I-749)+(3.013)+(17.010), (I-749)+(3.013)+(17.011), (I-749)+(3.013)+(17.012), (I-749)+(3.013)+(18.001),

(I-749)+(3.014)+(3.025), (I-749)+(3.014)+(3.030), (I-749)+(3.014)+(3.031), (I-749)+(3.014)+(5.001), (I-749)+(3.014)+(5.002), (I-749)+(3.014)+(5.003), (I-749)+(3.014)+(5.004), (I-749)+(3.014)+(5.005), (I-749)+(3.014)+(5.006), (I-749)+(3.014)+(5.007), (I-749)+(3.014)+(5.008), (I-749)+(3.014)+(5.009), (I-749)+(3.014)+(5.010), (I-749)+(3.014)+(5.011), (I-749)+(3.014)+(5.012), (I-749)+(3.014)+(5.013), (I-749)+(3.014)+(5.014), (I-749)+(3.014)+(5.015), (I-749)+(3.014)+(5.016), (I-749)+(3.014)+(5.017), (I-749)+(3.014)+(5.018), (I-749)+(3.014)+(5.019), (I-749)+(3.014)+(5.020), (I-749)+(3.014)+(5.021), (I-749)+(3.014)+(5.022), (I-749)+(3.014)+(5.023), (I-749)+(3.014)+(6.001), (I-749)+(3.014)+(6.002), (I-749)+(3.014)+(6.003), (I-749)+(3.014)+(6.004), (I-749)+(3.014)+(7.001), (I-749)+(3.014)+(7.002), (I-749)+(3.014)+(7.003), (I-749)+(3.014)+(7.004), (I-749)+(3.014)+(7.005), (I-749)+(3.014)+(7.006), (I-749)+(3.014)+(9.001), (I-749)+(3.014)+(9.002), (I-749)+(3.014)+(9.003), (I-749)+(3.014)+(9.004), (I-749)+(3.014)+(9.005), (I-749)+(3.014)+(9.006), (I-749)+(3.014)+(9.007), (I-749)+(3.014)+(9.008), (I-749)+(3.014)+(9.009), (I-749)+(3.014)+(14.001), (I-749)+(3.014)+(14.002), (I-749)+(3.014)+(15.008), (I-749)+(3.014)+(15.011), (I-749)+(3.014)+(15.012), (I-749)+(3.014)+(15.016), (I-749)+(3.014)+(15.025), (I-749)+(3.014)+(15.027), (I-749)+(3.014)+(15.047), (I-749)+(3.014)+(15.063), (I-749)+(3.014)+(15.064), (I-749)+(3.014)+(16.001), (I-749)+(3.014)+(16.002), (I-749)+(3.014)+(16.003), (I-749)+(3.014)+(16.004), (I-749)+(3.014)+(16.005), (I-749)+(3.014)+(16.006), (I-749)+(3.014)+(16.007), (I-749)+(3.014)+(16.008), (I-749)+(3.014)+(17.001), (I-749)+(3.014)+(17.002), (I-749)+(3.014)+(17.003), (I-749)+(3.014)+(17.004), (I-749)+(3.014)+(17.005), (I-749)+(3.014)+(17.006), (I-749)+(3.014)+(17.007), (I-749)+(3.014)+(17.008), (I-749)+(3.014)+(17.009), (I-749)+(3.014)+(17.010), (I-749)+(3.014)+(17.011), (I-749)+(3.014)+(17.012), (I-749)+(3.014)+(18.001),

(I-749)+(3.015)+(3.025), (I-749)+(3.015)+(3.030), (I-749)+(3.015)+(3.031), (I-749)+(3.015)+(5.001), (I-749)+(3.015)+(5.002), (I-749)+(3.015)+(5.003), (I-749)+(3.015)+(5.004), (I-749)+(3.015)+(5.005), (I-749)+(3.015)+(5.006), (I-749)+(3.015)+(5.007), (I-749)+(3.015)+(5.008), (I-749)+(3.015)+(5.009), (I-749)+(3.015)+(5.010), (I-749)+(3.015)+(5.011), (I-749)+(3.015)+(5.012), (I-749)+(3.015)+(5.013), (I-749)+(3.015)+(5.014), (I-749)+(3.015)+(5.015), (I-749)+(3.015)+(5.016), (I-749)+(3.015)+(5.017), (I-749)+(3.015)+(5.018), (I-749)+(3.015)+(5.019), (I-749)+(3.015)+(5.020), (I-749)+(3.015)+(5.021), (I-749)+(3.015)+(5.022), (I-749)+(3.015)+(5.023), (I-749)+(3.015)+(6.001), (I-749)+(3.015)+(6.002), (I-749)+(3.015)+(6.003), (I-749)+(3.015)+(6.004), (I-749)+(3.015)+(7.001), (I-749)+(3.015)+(7.002), (I-749)+(3.015)+(7.003), (I-749)+(3.015)+(7.004), (I-749)+(3.015)+(7.005), (I-749)+(3.015)+(7.006), (I-749)+(3.015)+(9.001), (I-749)+(3.015)+(9.002), (I-749)+(3.015)+(9.003), (I-749)+(3.015)+(9.004), (I-749)+(3.015)+(9.005), (I-749)+(3.015)+(9.006), (I-749)+(3.015)+(9.007), (I-749)+(3.015)+(9.008), (I-749)+(3.015)+(9.009), (I-749)+(3.015)+(14.001), (I-749)+(3.015)+(14.002), (I-749)+(3.015)+(15.008), (I-749)+(3.015)+(15.011), (I-749)+(3.015)+(15.012), (I-749)+(3.015)+(15.016), (I-749)+(3.015)+(15.025), (I-749)+(3.015)+(15.027), (I-749)+(3.015)+(15.047), (I-749)+(3.015)+(15.063), (I-749)+(3.015)+(15.064), (I-749)+(3.015)+(16.001), (I-749)+(3.015)+(16.002), (I-749)+(3.015)+(16.003), (I-749)+(3.015)+(16.004), (I-749)+(3.015)+(16.005), (I-749)+(3.015)+(16.006), (I-749)+(3.015)+(16.007), (I-749)+(3.015)+(16.008), (I-749)+(3.015)+(17.001), (I-749)+(3.015)+(17.002), (I-749)+(3.015)+(17.003), (I-749)+(3.015)+(17.004), (I-749)+(3.015)+(17.005), (I-749)+(3.015)+(17.006), (I-749)+(3.015)+(17.007), (I-749)+(3.015)+(17.008), (I-749)+(3.015)+(17.009), (I-749)+(3.015)+(17.010), (I-749)+(3.015)+(17.011), (I-749)+(3.015)+(17.012), (I-749)+(3.015)+(18.001),

(I-749)+(3.016)+(3.025), (I-749)+(3.016)+(3.030), (I-749)+(3.016)+(3.031), (I-749)+(3.016)+(5.001), (I-749)+(3.016)+(5.002), (I-749)+(3.016)+(5.003), (I-749)+(3.016)+(5.004), (I-749)+(3.016)+(5.005), (I-749)+(3.016)+(5.006), (I-749)+(3.016)+(5.007), (I-749)+(3.016)+(5.008), (I-749)+(3.016)+(5.009), (I-749)+(3.016)+(5.010), (I-749)+(3.016)+(5.011), (I-749)+(3.016)+(5.012), (I-749)+(3.016)+(5.013), (I-749)+(3.016)+(5.014), (I-749)+(3.016)+(5.015), (I-749)+(3.016)+(5.016), (I-749)+(3.016)+(5.017), (I-749)+(3.016)+(5.018), (I-749)+(3.016)+(5.019), (I-749)+(3.016)+(5.020), (I-749)+(3.016)+(5.021), (I-749)+(3.016)+(5.022), (I-749)+(3.016)+(5.023), (I-749)+(3.016)+(6.001), (I-749)+(3.016)+(6.002), (I-749)+(3.016)+(6.003), (I-749)+(3.016)+(6.004), (I-749)+(3.016)+(7.001), (I-749)+(3.016)+(7.002), (I-749)+(3.016)+(7.003), (I-749)+(3.016)+(7.004), (I-749)+(3.016)+(7.005), (I-749)+(3.016)+(7.006), (I-749)+(3.016)+(9.001), (I-749)+(3.016)+(9.002), (I-749)+(3.016)+(9.003), (I-749)+(3.016)+(9.004), (I-749)+(3.016)+(9.005), (I-749)+(3.016)+(9.006), (I-749)+(3.016)+(9.007), (I-749)+(3.016)+(9.008), (I-749)+(3.016)+(9.009), (I-749)+(3.016)+(14.001), (I-749)+(3.016)+(14.002), (I-749)+(3.016)+(15.008), (I-749)+(3.016)+(15.011), (I-749)+(3.016)+(15.012), (I-749)+(3.016)+(15.016), (I-749)+(3.016)+(15.025), (I-749)+(3.016)+(15.027), (I-749)+(3.016)+(15.047), (I-749)+(3.016)+(15.063), (I-749)+(3.016)+(15.064), (I-749)+(3.016)+(16.001), (I-749)+(3.016)+(16.002), (I-749)+(3.016)+(16.003), (I-749)+(3.016)+(16.004), (I-749)+(3.016)+(16.005), (I-749)+(3.016)+(16.006), (I-749)+(3.016)+(16.007), (I-749)+(3.016)+(16.008), (I-749)+(3.016)+(17.001), (I-749)+(3.016)+(17.002), (I-749)+(3.016)+(17.003), (I-749)+(3.016)+(17.004), (I-749)+(3.016)+(17.005), (I-749)+(3.016)+(17.006), (I-749)+(3.016)+(17.007), (I-749)+(3.016)+(17.008), (I-749)+(3.016)+(17.009), (I-749)+(3.016)+(17.010), (I-749)+(3.016)+(17.011), (I-749)+(3.016)+(17.012), (I-749)+(3.016)+(18.001),

(I-749)+(3.017)+(3.025), (I-749)+(3.017)+(3.030), (I-749)+(3.017)+(3.031), (I-749)+(3.017)+(5.001), (I-749)+(3.017)+(5.002), (I-749)+(3.017)+(5.003), (I-749)+(3.017)+(5.004), (I-749)+(3.017)+(5.005), (I-749)+(3.017)+(5.006), (I-749)+(3.017)+(5.007), (I-749)+(3.017)+(5.008), (I-749)+(3.017)+(5.009), (I-749)+(3.017)+(5.010), (I-749)+(3.017)+(5.011), (I-749)+(3.017)+(5.012), (I-749)+(3.017)+(5.013), (I-749)+(3.017)+(5.014), (I-749)+(3.017)+(5.015), (I-749)+(3.017)+(5.016), (I-749)+(3.017)+(5.017), (I-749)+(3.017)+(5.018), (I-749)+(3.017)+(5.019), (I-749)+(3.017)+(5.020), (I-749)+(3.017)+(5.021), (I-749)+(3.017)+(5.022), (I-749)+(3.017)+(5.023), (I-749)+(3.017)+(6.001), (I-749)+(3.017)+(6.002), (I-749)+(3.017)+(6.003), (I-749)+(3.017)+(6.004), (I-749)+(3.017)+(7.001), (I-749)+(3.017)+(7.002), (I-749)+(3.017)+(7.003), (I-749)+(3.017)+(7.004), (I-749)+(3.017)+(7.005), (I-749)+(3.017)+(7.006), (I-749)+(3.017)+(9.001), (I-749)+(3.017)+(9.002), (I-749)+(3.017)+(9.003), (I-749)+(3.017)+(9.004), (I-749)+(3.017)+(9.005), (I-749)+(3.017)+(9.006), (I-749)+(3.017)+(9.007), (I-749)+(3.017)+(9.008), (I-749)+(3.017)+(9.009), (I-749)+(3.017)+(14.001), (I-749)+(3.017)+(14.002), (I-749)+(3.017)+(15.008), (I-749)+(3.017)+(15.011), (I-749)+(3.017)+(15.012), (I-749)+(3.017)+(15.016), (I-749)+(3.017)+(15.025), (I-749)+(3.017)+(15.027), (I-749)+(3.017)+(15.047), (I-749)+(3.017)+(15.063), (I-749)+(3.017)+(15.064), (I-749)+(3.017)+(16.001), (I-749)+(3.017)+(16.002), (I-749)+(3.017)+(16.003), (I-749)+(3.017)+(16.004), (I-749)+(3.017)+(16.005), (I-749)+(3.017)+(16.006), (I-749)+(3.017)+(16.007), (I-749)+(3.017)+(16.008), (I-749)+(3.017)+(17.001), (I-749)+(3.017)+(17.002), (I-749)+(3.017)+(17.003), (I-749)+(3.017)+(17.004), (I-749)+(3.017)+(17.005), (I-749)+(3.017)+(17.006), (I-749)+(3.017)+(17.007), (I-749)+(3.017)+(17.008), (I-749)+(3.017)+(17.009), (I-749)+(3.017)+(17.010), (I-749)+(3.017)+(17.011), (I-749)+(3.017)+(17.012), (I-749)+(3.017)+(18.001),

(I-749)+(3.018)+(3.025), (I-749)+(3.018)+(3.030), (I-749)+(3.018)+(3.031), (I-749)+(3.018)+(5.001), (I-749)+(3.018)+(5.002), (I-749)+(3.018)+(5.003), (I-749)+(3.018)+(5.004), (I-749)+(3.018)+(5.005), (I-749)+(3.018)+(5.006), (I-749)+(3.018)+(5.007), (I-749)+(3.018)+(5.008), (I-749)+(3.018)+(5.009), (I-749)+(3.018)+(5.010), (I-749)+(3.018)+(5.011), (I-749)+(3.018)+(5.012), (I-749)+(3.018)+(5.013), (I-749)+(3.018)+(5.014), (I-749)+(3.018)+(5.015), (I-749)+(3.018)+(5.016), (I-749)+(3.018)+(5.017), (I-749)+(3.018)+(5.018), (I-749)+(3.018)+(5.019), (I-749)+(3.018)+(5.020), (I-749)+(3.018)+(5.021), (I-749)+(3.018)+(5.022), (I-749)+(3.018)+(5.023), (I-749)+(3.018)+(6.001), (I-749)+(3.018)+(6.002), (I-749)+(3.018)+(6.003), (I-749)+(3.018)+(6.004), (I-749)+(3.018)+(7.001), (I-749)+(3.018)+(7.002), (I-749)+(3.018)+(7.003), (I-749)+(3.018)+(7.004), (I-749)+(3.018)+(7.005), (I-749)+(3.018)+(7.006), (I-749)+(3.018)+(9.001), (I-749)+(3.018)+(9.002), (I-749)+(3.018)+(9.003), (I-749)+(3.018)+(9.004), (I-749)+(3.018)+(9.005), (I-749)+(3.018)+(9.006), (I-749)+(3.018)+(9.007), (I-749)+(3.018)+(9.008), (I-749)+(3.018)+(9.009), (I-749)+(3.018)+(14.001), (I-749)+(3.018)+(14.002), (I-749)+(3.018)+(15.008), (I-749)+(3.018)+(15.011), (I-749)+(3.018)+(15.012), (I-749)+(3.018)+(15.016), (I-749)+(3.018)+(15.025), (I-749)+(3.018)+(15.027), (I-749)+(3.018)+(15.047), (I-749)+(3.018)+(15.063), (I-749)+(3.018)+(15.064), (I-749)+(3.018)+(16.001), (I-749)+(3.018)+(16.002), (I-749)+(3.018)+(16.003), (I-749)+(3.018)+(16.004), (I-749)+(3.018)+(16.005), (I-749)+(3.018)+(16.006), (I-749)+(3.018)+(16.007), (I-749)+(3.018)+(16.008), (I-749)+(3.018)+(17.001), (I-749)+(3.018)+(17.002), (I-749)+(3.018)+(17.003), (I-749)+(3.018)+(17.004), (I-749)+(3.018)+(17.005), (I-749)+(3.018)+(17.006), (I-749)+(3.018)+(17.007), (I-749)+(3.018)+(17.008), (I-749)+(3.018)+(17.009), (I-749)+(3.018)+(17.010), (I-749)+(3.018)+(17.011), (I-749)+(3.018)+(17.012), (I-749)+(3.018)+(18.001),

(I-749)+(3.019)+(3.025), (I-749)+(3.019)+(3.030), (I-749)+(3.019)+(3.031), (I-749)+(3.019)+(5.001), (I-749)+(3.019)+(5.002), (I-749)+(3.019)+(5.003), (I-749)+(3.019)+(5.004), (I-749)+(3.019)+(5.005), (I-749)+(3.019)+(5.006), (I-749)+(3.019)+(5.007), (I-749)+(3.019)+(5.008), (I-749)+(3.019)+(5.009), (I-749)+(3.019)+(5.010), (I-749)+(3.019)+(5.011), (I-749)+(3.019)+(5.012), (I-749)+(3.019)+(5.013), (I-749)+(3.019)+(5.014), (I-749)+(3.019)+(5.015), (I-749)+(3.019)+(5.016), (I-749)+(3.019)+(5.017), (I-749)+(3.019)+(5.018), (I-749)+(3.019)+(5.019), (I-749)+(3.019)+(5.020), (I-749)+(3.019)+(5.021), (I-749)+(3.019)+(5.022), (I-749)+(3.019)+(5.023), (I-749)+(3.019)+(6.001), (I-749)+(3.019)+(6.002), (I-749)+(3.019)+(6.003), (I-749)+(3.019)+(6.004), (I-749)+(3.019)+(7.001), (I-749)+(3.019)+(7.002), (I-749)+(3.019)+(7.003), (I-749)+(3.019)+(7.004), (I-749)+(3.019)+(7.005), (I-749)+(3.019)+(7.006), (I-749)+(3.019)+(9.001), (I-749)+(3.019)+(9.002), (I-749)+(3.019)+(9.003), (I-749)+(3.019)+(9.004), (I-749)+(3.019)+(9.005), (I-749)+(3.019)+(9.006), (I-749)+(3.019)+(9.007), (I-749)+(3.019)+(9.008), (I-749)+(3.019)+(9.009), (I-749)+(3.019)+(14.001), (I-749)+(3.019)+(14.002), (I-749)+(3.019)+(15.008), (I-749)+(3.019)+(15.011), (I-749)+(3.019)+(15.012), (I-749)+(3.019)+(15.016), (I-749)+(3.019)+(15.025), (I-749)+(3.019)+(15.027), (I-749)+(3.019)+(15.047), (I-749)+(3.019)+(15.063), (I-749)+(3.019)+(15.064), (I-749)+(3.019)+(16.001), (I-749)+(3.019)+(16.002), (I-749)+(3.019)+(16.003), (I-749)+(3.019)+(16.004), (I-749)+(3.019)+(16.005), (I-749)+(3.019)+(16.006), (I-749)+(3.019)+(16.007), (I-749)+(3.019)+(16.008), (I-749)+(3.019)+(17.001), (I-749)+(3.019)+(17.002), (I-749)+(3.019)+(17.003), (I-749)+(3.019)+(17.004), (I-749)+(3.019)+(17.005), (I-749)+(3.019)+(17.006), (I-749)+(3.019)+(17.007), (I-749)+(3.019)+(17.008), (I-749)+(3.019)+(17.009), (I-749)+(3.019)+(17.010), (I-749)+(3.019)+(17.011), (I-749)+(3.019)+(17.012), (I-749)+(3.019)+(18.001),

(I-749)+(3.020)+(3.025), (I-749)+(3.020)+(3.030), (I-749)+(3.020)+(3.031), (I-749)+(3.020)+(5.001), (I-749)+(3.020)+(5.002), (I-749)+(3.020)+(5.003), (I-749)+(3.020)+(5.004), (I-749)+(3.020)+(5.005), (I-749)+(3.020)+(5.006), (I-749)+(3.020)+(5.007), (I-749)+(3.020)+(5.008), (I-749)+(3.020)+(5.009), (I-749)+(3.020)+(5.010), (I-749)+(3.020)+(5.011), (I-749)+(3.020)+(5.012), (I-749)+(3.020)+(5.013), (I-749)+(3.020)+(5.014), (I-749)+(3.020)+(5.015), (I-749)+(3.020)+(5.016), (I-749)+(3.020)+(5.017), (I-749)+(3.020)+(5.018), (I-749)+(3.020)+(5.019), (I-749)+(3.020)+(5.020), (I-749)+(3.020)+(5.021), (I-749)+(3.020)+(5.022), (I-749)+(3.020)+(5.023), (I-749)+(3.020)+(6.001), (I-749)+(3.020)+(6.002), (I-749)+(3.020)+(6.003), (I-749)+(3.020)+(6.004), (I-749)+(3.020)+(7.001), (I-749)+(3.020)+(7.002), (I-749)+(3.020)+(7.003), (I-749)+(3.020)+(7.004), (I-749)+(3.020)+(7.005), (I-749)+(3.020)+(7.006), (I-749)+(3.020)+(9.001), (I-749)+(3.020)+(9.002), (I-749)+(3.020)+(9.003), (I-749)+(3.020)+(9.004), (I-749)+(3.020)+(9.005), (I-749)+(3.020)+(9.006), (I-749)+(3.020)+(9.007), (I-749)+(3.020)+(9.008), (I-749)+(3.020)+(9.009), (I-749)+(3.020)+(14.001), (I-749)+(3.020)+(14.002), (I-749)+(3.020)+(15.008), (I-749)+(3.020)+(15.011), (I-749)+(3.020)+(15.012), (I-749)+(3.020)+(15.016), (I-749)+(3.020)+(15.025), (I-749)+(3.020)+(15.027), (I-749)+(3.020)+(15.047), (I-749)+(3.020)+(15.063), (I-749)+(3.020)+(15.064), (I-749)+(3.020)+(16.001), (I-749)+(3.020)+(16.002), (I-749)+(3.020)+(16.003), (I-749)+(3.020)+(16.004), (I-749)+(3.020)+(16.005), (I-749)+(3.020)+(16.006), (I-749)+(3.020)+(16.007), (I-749)+(3.020)+(16.008), (I-749)+(3.020)+(17.001), (I-749)+(3.020)+(17.002), (I-749)+(3.020)+(17.003), (I-749)+(3.020)+(17.004), (I-749)+(3.020)+(17.005), (I-749)+(3.020)+(17.006), (I-749)+(3.020)+(17.007), (I-749)+(3.020)+(17.008), (I-749)+(3.020)+(17.009), (I-749)+(3.020)+(17.010), (I-749)+(3.020)+(17.011), (I-749)+(3.020)+(17.012), (I-749)+(3.020)+(18.001),

(I-749)+(3.021)+(3.025), (I-749)+(3.021)+(3.030), (I-749)+(3.021)+(3.031), (I-749)+(3.021)+(5.001), (I-749)+(3.021)+(5.002), (I-749)+(3.021)+(5.003), (I-749)+(3.021)+(5.004), (I-749)+(3.021)+(5.005), (I-749)+(3.021)+(5.006), (I-749)+(3.021)+(5.007), (I-749)+(3.021)+(5.008), (I-749)+(3.021)+(5.009), (I-749)+(3.021)+(5.010), (I-749)+(3.021)+(5.011), (I-749)+(3.021)+(5.012), (I-749)+(3.021)+(5.013), (I-749)+(3.021)+(5.014), (I-749)+(3.021)+(5.015), (I-749)+(3.021)+(5.016), (I-749)+(3.021)+(5.017), (I-749)+(3.021)+(5.018), (I-749)+(3.021)+(5.019), (I-749)+(3.021)+(5.020), (I-749)+(3.021)+(5.021), (I-749)+(3.021)+(5.022), (I-749)+(3.021)+(5.023), (I-749)+(3.021)+(6.001), (I-749)+(3.021)+(6.002), (I-749)+(3.021)+(6.003), (I-749)+(3.021)+(6.004), (I-749)+(3.021)+(7.001), (I-749)+(3.021)+(7.002), (I-749)+(3.021)+(7.003), (I-749)+(3.021)+(7.004), (I-749)+(3.021)+(7.005), (I-749)+(3.021)+(7.006), (I-749)+(3.021)+(9.001), (I-749)+(3.021)+(9.002), (I-749)+(3.021)+(9.003), (I-749)+(3.021)+(9.004), (I-749)+(3.021)+(9.005), (I-749)+(3.021)+(9.006), (I-749)+(3.021)+(9.007), (I-749)+(3.021)+(9.008), (I-749)+(3.021)+(9.009), (I-749)+(3.021)+(14.001), (I-749)+(3.021)+(14.002), (I-749)+(3.021)+(15.008), (I-749)+(3.021)+(15.011), (I-749)+(3.021)+(15.012), (I-749)+(3.021)+(15.016), (I-749)+(3.021)+(15.025), (I-749)+(3.021)+(15.027), (I-749)+(3.021)+(15.047), (I-749)+(3.021)+(15.063), (I-749)+(3.021)+(15.064), (I-749)+(3.021)+(16.001), (I-749)+(3.021)+(16.002), (I-749)+(3.021)+(16.003), (I-749)+(3.021)+(16.004), (I-749)+(3.021)+(16.005), (I-749)+(3.021)+(16.006), (I-749)+(3.021)+(16.007), (I-749)+(3.021)+(16.008), (I-749)+(3.021)+(17.001), (I-749)+(3.021)+(17.002), (I-749)+(3.021)+(17.003), (I-749)+(3.021)+(17.004), (I-749)+(3.021)+(17.005), (I-749)+(3.021)+(17.006), (I-749)+(3.021)+(17.007), (I-749)+(3.021)+(17.008), (I-749)+(3.021)+(17.009), (I-749)+(3.021)+(17.010), (I-749)+(3.021)+(17.011), (I-749)+(3.021)+(17.012), (I-749)+(3.021)+(18.001),

(I-749)+(3.022)+(3.025), (I-749)+(3.022)+(3.030), (I-749)+(3.022)+(3.031), (I-749)+(3.022)+(5.001), (I-749)+(3.022)+(5.002), (I-749)+(3.022)+(5.003), (I-749)+(3.022)+(5.004), (I-749)+(3.022)+(5.005), (I-749)+(3.022)+(5.006), (I-749)+(3.022)+(5.007), (I-749)+(3.022)+(5.008), (I-749)+(3.022)+(5.009), (I-749)+(3.022)+(5.010), (I-749)+(3.022)+(5.011), (I-749)+(3.022)+(5.012), (I-749)+(3.022)+(5.013), (I-749)+(3.022)+(5.014), (I-749)+(3.022)+(5.015), (I-749)+(3.022)+(5.016), (I-749)+(3.022)+(5.017), (I-749)+(3.022)+(5.018), (I-749)+(3.022)+(5.019), (I-749)+(3.022)+(5.020), (I-749)+(3.022)+(5.021), (I-749)+(3.022)+(5.022), (I-749)+(3.022)+(5.023), (I-749)+(3.022)+(6.001), (I-749)+(3.022)+(6.002), (I-749)+(3.022)+(6.003), (I-749)+(3.022)+(6.004), (I-749)+(3.022)+(7.001), (I-749)+(3.022)+(7.002), (I-749)+(3.022)+(7.003), (I-749)+(3.022)+(7.004), (I-749)+(3.022)+(7.005), (I-749)+(3.022)+(7.006), (I-749)+(3.022)+(9.001), (I-749)+(3.022)+(9.002), (I-749)+(3.022)+(9.003), (I-749)+(3.022)+(9.004), (I-749)+(3.022)+(9.005), (I-749)+(3.022)+(9.006), (I-749)+(3.022)+(9.007), (I-749)+(3.022)+(9.008), (I-749)+(3.022)+(9.009), (I-749)+(3.022)+(14.001), (I-749)+(3.022)+(14.002), (I-749)+(3.022)+(15.008), (I-749)+(3.022)+(15.011), (I-749)+(3.022)+(15.012), (I-749)+(3.022)+(15.016), (I-749)+(3.022)+(15.025), (I-749)+(3.022)+(15.027), (I-749)+(3.022)+(15.047), (I-749)+(3.022)+(15.063), (I-749)+(3.022)+(15.064), (I-749)+(3.022)+(16.001), (I-749)+(3.022)+(16.002), (I-749)+(3.022)+(16.003), (I-749)+(3.022)+(16.004), (I-749)+(3.022)+(16.005), (I-749)+(3.022)+(16.006), (I-749)+(3.022)+(16.007), (I-749)+(3.022)+(16.008), (I-749)+(3.022)+(17.001), (I-749)+(3.022)+(17.002), (I-749)+(3.022)+(17.003), (I-749)+(3.022)+(17.004), (I-749)+(3.022)+(17.005), (I-749)+(3.022)+(17.006), (I-749)+(3.022)+(17.007), (I-749)+(3.022)+(17.008), (I-749)+(3.022)+(17.009), (I-749)+(3.022)+(17.010), (I-749)+(3.022)+(17.011), (I-749)+(3.022)+(17.012), (I-749)+(3.022)+(18.001),

(I-749)+(3.023)+(3.025), (I-749)+(3.023)+(3.030), (I-749)+(3.023)+(3.031), (I-749)+(3.023)+(5.001), (I-749)+(3.023)+(5.002), (I-749)+(3.023)+(5.003), (I-749)+(3.023)+(5.004), (I-749)+(3.023)+(5.005), (I-749)+(3.023)+(5.006), (I-749)+(3.023)+(5.007), (I-749)+(3.023)+(5.008), (I-749)+(3.023)+(5.009), (I-749)+(3.023)+(5.010), (I-749)+(3.023)+(5.011), (I-749)+(3.023)+(5.012), (I-749)+(3.023)+(5.013), (I-749)+(3.023)+(5.014), (I-749)+(3.023)+(5.015), (I-749)+(3.023)+(5.016), (I-749)+(3.023)+(5.017), (I-749)+(3.023)+(5.018), (I-749)+(3.023)+(5.019), (I-749)+(3.023)+(5.020), (I-749)+(3.023)+(5.021), (I-749)+(3.023)+(5.022), (I-749)+(3.023)+(5.023), (I-749)+(3.023)+(6.001), (I-749)+(3.023)+(6.002), (I-749)+(3.023)+(6.003), (I-749)+(3.023)+(6.004), (I-749)+(3.023)+(7.001), (I-749)+(3.023)+(7.002), (I-749)+(3.023)+(7.003), (I-749)+(3.023)+(7.004), (I-749)+(3.023)+(7.005), (I-749)+(3.023)+(7.006), (I-749)+(3.023)+(9.001), (I-749)+(3.023)+(9.002), (I-749)+(3.023)+(9.003), (I-749)+(3.023)+(9.004), (I-749)+(3.023)+(9.005), (I-749)+(3.023)+(9.006), (I-749)+(3.023)+(9.007), (I-749)+(3.023)+(9.008), (I-749)+(3.023)+(9.009), (I-749)+(3.023)+(14.001), (I-749)+(3.023)+(14.002), (I-749)+(3.023)+(15.008), (I-749)+(3.023)+(15.011), (I-749)+(3.023)+(15.012), (I-749)+(3.023)+(15.016), (I-749)+(3.023)+(15.025), (I-749)+(3.023)+(15.027), (I-749)+(3.023)+(15.047), (I-749)+(3.023)+(15.063), (I-749)+(3.023)+(15.064), (I-749)+(3.023)+(16.001), (I-749)+(3.023)+(16.002), (I-749)+(3.023)+(16.003), (I-749)+(3.023)+(16.004), (I-749)+(3.023)+(16.005), (I-749)+(3.023)+(16.006), (I-749)+(3.023)+(16.007), (I-749)+(3.023)+(16.008), (I-749)+(3.023)+(17.001), (I-749)+(3.023)+(17.002), (I-749)+(3.023)+(17.003), (I-749)+(3.023)+(17.004), (I-749)+(3.023)+(17.005), (I-749)+(3.023)+(17.006), (I-749)+(3.023)+(17.007), (I-749)+(3.023)+(17.008), (I-749)+(3.023)+(17.009), (I-749)+(3.023)+(17.010), (I-749)+(3.023)+(17.011), (I-749)+(3.023)+(17.012), (I-749)+(3.023)+(18.001),

(I-749)+(3.024)+(3.025), (I-749)+(3.024)+(3.030), (I-749)+(3.024)+(3.031), (I-749)+(3.024)+(5.001), (I-749)+(3.024)+(5.002), (I-749)+(3.024)+(5.003), (I-749)+(3.024)+(5.004), (I-749)+(3.024)+(5.005), (I-749)+(3.024)+(5.006), (I-749)+(3.024)+(5.007), (I-749)+(3.024)+(5.008), (I-749)+(3.024)+(5.009), (I-749)+(3.024)+(5.010), (I-749)+(3.024)+(5.011), (I-749)+(3.024)+(5.012), (I-749)+(3.024)+(5.013), (I-749)+(3.024)+(5.014), (I-749)+(3.024)+(5.015), (I-749)+(3.024)+(5.016), (I-749)+(3.024)+(5.017), (I-749)+(3.024)+(5.018), (I-749)+(3.024)+(5.019), (I-749)+(3.024)+(5.020), (I-749)+(3.024)+(5.021), (I-749)+(3.024)+(5.022), (I-749)+(3.024)+(5.023), (I-749)+(3.024)+(6.001), (I-749)+(3.024)+(6.002), (I-749)+(3.024)+(6.003), (I-749)+(3.024)+(6.004), (I-749)+(3.024)+(7.001), (I-749)+(3.024)+(7.002), (I-749)+(3.024)+(7.003), (I-749)+(3.024)+(7.004), (I-749)+(3.024)+(7.005), (I-749)+(3.024)+(7.006), (I-749)+(3.024)+(9.001), (I-749)+(3.024)+(9.002), (I-749)+(3.024)+(9.003), (I-749)+(3.024)+(9.004), (I-749)+(3.024)+(9.005), (I-749)+(3.024)+(9.006), (I-749)+(3.024)+(9.007), (I-749)+(3.024)+(9.008), (I-749)+(3.024)+(9.009), (I-749)+(3.024)+(14.001), (I-749)+(3.024)+(14.002), (I-749)+(3.024)+(15.008), (I-749)+(3.024)+(15.011), (I-749)+(3.024)+(15.012), (I-749)+(3.024)+(15.016), (I-749)+(3.024)+(15.025), (I-749)+(3.024)+(15.027), (I-749)+(3.024)+(15.047), (I-749)+(3.024)+(15.063), (I-749)+(3.024)+(15.064), (I-749)+(3.024)+(16.001), (I-749)+(3.024)+(16.002), (I-749)+(3.024)+(16.003), (I-749)+(3.024)+(16.004), (I-749)+(3.024)+(16.005), (I-749)+(3.024)+(16.006), (I-749)+(3.024)+(16.007), (I-749)+(3.024)+(16.008), (I-749)+(3.024)+(17.001), (I-749)+(3.024)+(17.002), (I-749)+(3.024)+(17.003), (I-749)+(3.024)+(17.004), (I-749)+(3.024)+(17.005), (I-749)+(3.024)+(17.006), (I-749)+(3.024)+(17.007), (I-749)+(3.024)+(17.008), (I-749)+(3.024)+(17.009), (I-749)+(3.024)+(17.010), (I-749)+(3.024)+(17.011), (I-749)+(3.024)+(17.012), (I-749)+(3.024)+(18.001),

(I-749)+(3.025)+(3.030), (I-749)+(3.025)+(3.031), (I-749)+(3.025)+(5.001), (I-749)+(3.025)+(5.002), (I-749)+(3.025)+(5.003), (I-749)+(3.025)+(5.004), (I-749)+(3.025)+(5.005), (I-749)+(3.025)+(5.006), (I-749)+(3.025)+(5.007), (I-749)+(3.025)+(5.008), (I-749)+(3.025)+(5.009), (I-749)+(3.025)+(5.010), (I-749)+(3.025)+(5.011), (I-749)+(3.025)+(5.012), (I-749)+(3.025)+(5.013), (I-749)+(3.025)+(5.014), (I-749)+(3.025)+(5.015), (I-749)+(3.025)+(5.016), (I-749)+(3.025)+(5.017), (I-749)+(3.025)+(5.018), (I-749)+(3.025)+(5.019), (I-749)+(3.025)+(5.020), (I-749)+(3.025)+(5.021), (I-749)+(3.025)+(5.022), (I-749)+(3.025)+(5.023), (I-749)+(3.025)+(6.001), (I-749)+(3.025)+(6.002), (I-749)+(3.025)+(6.003), (I-749)+(3.025)+(6.004), (I-749)+(3.025)+(7.001), (I-749)+(3.025)+(7.002), (I-749)+(3.025)+(7.003), (I-749)+(3.025)+(7.004), (I-749)+(3.025)+(7.005), (I-749)+(3.025)+(7.006), (I-749)+(3.025)+(9.001), (I-749)+(3.025)+(9.002), (I-749)+(3.025)+(9.003), (I-749)+(3.025)+(9.004), (I-749)+(3.025)+(9.005), (I-749)+(3.025)+(9.006), (I-749)+(3.025)+(9.007), (I-749)+(3.025)+(9.008), (I-749)+(3.025)+(9.009), (I-749)+(3.025)+(14.001), (I-749)+(3.025)+(14.002), (I-749)+(3.025)+(15.008), (I-749)+(3.025)+(15.011), (I-749)+(3.025)+(15.012), (I-749)+(3.025)+(15.016), (I-749)+(3.025)+(15.025), (I-749)+(3.025)+(15.027), (I-749)+(3.025)+(15.047), (I-749)+(3.025)+(15.063), (I-749)+(3.025)+(15.064), (I-749)+(3.025)+(16.001), (I-749)+(3.025)+(16.002), (I-749)+(3.025)+(16.003), (I-749)+(3.025)+(16.004), (I-749)+(3.025)+(16.005), (I-749)+(3.025)+(16.006), (I-749)+(3.025)+(16.007), (I-749)+(3.025)+(16.008), (I-749)+(3.025)+(17.001), (I-749)+(3.025)+(17.002), (I-749)+(3.025)+(17.003), (I-749)+(3.025)+(17.004), (I-749)+(3.025)+(17.005), (I-749)+(3.025)+(17.006), (I-749)+(3.025)+(17.007), (I-749)+(3.025)+(17.008), (I-749)+(3.025)+(17.009), (I-749)+(3.025)+(17.010), (I-749)+(3.025)+(17.011), (I-749)+(3.025)+(17.012), (I-749)+(3.025)+(18.001),

(I-749)+(3.026)+(3.025), (I-749)+(3.026)+(3.030), (I-749)+(3.026)+(3.031), (I-749)+(3.026)+(5.001), (I-749)+(3.026)+(5.002), (I-749)+(3.026)+(5.003), (I-749)+(3.026)+(5.004), (I-749)+(3.026)+(5.005), (I-749)+(3.026)+(5.006), (I-749)+(3.026)+(5.007), (I-749)+(3.026)+(5.008), (I-749)+(3.026)+(5.009), (I-749)+(3.026)+(5.010), (I-749)+(3.026)+(5.011), (I-749)+(3.026)+(5.012), (I-749)+(3.026)+(5.013), (I-749)+(3.026)+(5.014), (I-749)+(3.026)+(5.015), (I-749)+(3.026)+(5.016), (I-749)+(3.026)+(5.017), (I-749)+(3.026)+(5.018), (I-749)+(3.026)+(5.019), (I-749)+(3.026)+(5.020), (I-749)+(3.026)+(5.021), (I-749)+(3.026)+(5.022), (I-749)+(3.026)+(5.023), (I-749)+(3.026)+(6.001), (I-749)+(3.026)+(6.002), (I-749)+(3.026)+(6.003), (I-749)+(3.026)+(6.004), (I-749)+(3.026)+(7.001), (I-749)+(3.026)+(7.002), (I-749)+(3.026)+(7.003), (I-749)+(3.026)+(7.004), (I-749)+(3.026)+(7.005), (I-749)+(3.026)+(7.006), (I-749)+(3.026)+(9.001), (I-749)+(3.026)+(9.002), (I-749)+(3.026)+(9.003), (I-749)+(3.026)+(9.004), (I-749)+(3.026)+(9.005), (I-749)+(3.026)+(9.006), (I-749)+(3.026)+(9.007), (I-749)+(3.026)+(9.008), (I-749)+(3.026)+(9.009), (I-749)+(3.026)+(14.001), (I-749)+(3.026)+(14.002), (I-749)+(3.026)+(15.008), (I-749)+(3.026)+(15.011), (I-749)+(3.026)+(15.012), (I-749)+(3.026)+(15.016), (I-749)+(3.026)+(15.025), (I-749)+(3.026)+(15.027), (I-749)+(3.026)+(15.047), (I-749)+(3.026)+(15.063), (I-749)+(3.026)+(15.064), (I-749)+(3.026)+(16.001), (I-749)+(3.026)+(16.002), (I-749)+(3.026)+(16.003), (I-749)+(3.026)+(16.004), (I-749)+(3.026)+(16.005), (I-749)+(3.026)+(16.006), (I-749)+(3.026)+(16.007), (I-749)+(3.026)+(16.008), (I-749)+(3.026)+(17.001), (I-749)+(3.026)+(17.002), (I-749)+(3.026)+(17.003), (I-749)+(3.026)+(17.004), (I-749)+(3.026)+(17.005), (I-749)+(3.026)+(17.006), (I-749)+(3.026)+(17.007), (I-749)+(3.026)+(17.008), (I-749)+(3.026)+(17.009), (I-749)+(3.026)+(17.010), (I-749)+(3.026)+(17.011), (I-749)+(3.026)+(17.012), (I-749)+(3.026)+(18.001),

(I-749)+(3.027)+(3.025), (I-749)+(3.027)+(3.030), (I-749)+(3.027)+(3.031), (I-749)+(3.027)+(5.001), (I-749)+(3.027)+(5.002), (I-749)+(3.027)+(5.003), (I-749)+(3.027)+(5.004), (I-749)+(3.027)+(5.005), (I-749)+(3.027)+(5.006), (I-749)+(3.027)+(5.007), (I-749)+(3.027)+(5.008), (I-749)+(3.027)+(5.009), (I-749)+(3.027)+(5.010), (I-749)+(3.027)+(5.011), (I-749)+(3.027)+(5.012), (I-749)+(3.027)+(5.013), (I-749)+(3.027)+(5.014), (I-749)+(3.027)+(5.015), (I-749)+(3.027)+(5.016), (I-749)+(3.027)+(5.017), (I-749)+(3.027)+(5.018), (I-749)+(3.027)+(5.019), (I-749)+(3.027)+(5.020), (I-749)+(3.027)+(5.021), (I-749)+(3.027)+(5.022), (I-749)+(3.027)+(5.023), (I-749)+(3.027)+(6.001), (I-749)+(3.027)+(6.002), (I-749)+(3.027)+(6.003), (I-749)+(3.027)+(6.004), (I-749)+(3.027)+(7.001), (I-749)+(3.027)+(7.002), (I-749)+(3.027)+(7.003), (I-749)+(3.027)+(7.004), (I-749)+(3.027)+(7.005), (I-749)+(3.027)+(7.006), (I-749)+(3.027)+(9.001), (I-749)+(3.027)+(9.002), (I-749)+(3.027)+(9.003), (I-749)+(3.027)+(9.004), (I-749)+(3.027)+(9.005), (I-749)+(3.027)+(9.006), (I-749)+(3.027)+(9.007), (I-749)+(3.027)+(9.008), (I-749)+(3.027)+(9.009), (I-749)+(3.027)+(14.001), (I-749)+(3.027)+(14.002), (I-749)+(3.027)+(15.008), (I-749)+(3.027)+(15.011), (I-749)+(3.027)+(15.012), (I-749)+(3.027)+(15.016), (I-749)+(3.027)+(15.025), (I-749)+(3.027)+(15.027), (I-749)+(3.027)+(15.047), (I-749)+(3.027)+(15.063), (I-749)+(3.027)+(15.064), (I-749)+(3.027)+(16.001), (I-749)+(3.027)+(16.002), (I-749)+(3.027)+(16.003), (I-749)+(3.027)+(16.004), (I-749)+(3.027)+(16.005), (I-749)+(3.027)+(16.006), (I-749)+(3.027)+(16.007), (I-749)+(3.027)+(16.008), (I-749)+(3.027)+(17.001), (I-749)+(3.027)+(17.002), (I-749)+(3.027)+(17.003), (I-749)+(3.027)+(17.004), (I-749)+(3.027)+(17.005), (I-749)+(3.027)+(17.006), (I-749)+(3.027)+(17.007), (I-749)+(3.027)+(17.008), (I-749)+(3.027)+(17.009), (I-749)+(3.027)+(17.010), (I-749)+(3.027)+(17.011), (I-749)+(3.027)+(17.012), (I-749)+(3.027)+(18.001),

(I-749)+(3.028)+(3.025), (I-749)+(3.028)+(3.030), (I-749)+(3.028)+(3.031), (I-749)+(3.028)+(5.001), (I-749)+(3.028)+(5.002), (I-749)+(3.028)+(5.003), (I-749)+(3.028)+(5.004), (I-749)+(3.028)+(5.005), (I-749)+(3.028)+(5.006), (I-749)+(3.028)+(5.007), (I-749)+(3.028)+(5.008), (I-749)+(3.028)+(5.009), (I-749)+(3.028)+(5.010), (I-749)+(3.028)+(5.011), (I-749)+(3.028)+(5.012), (I-749)+(3.028)+(5.013), (I-749)+(3.028)+(5.014), (I-749)+(3.028)+(5.015), (I-749)+(3.028)+(5.016), (I-749)+(3.028)+(5.017), (I-749)+(3.028)+(5.018), (I-749)+(3.028)+(5.019), (I-749)+(3.028)+(5.020), (I-749)+(3.028)+(5.021), (I-749)+(3.028)+(5.022), (I-749)+(3.028)+(5.023), (I-749)+(3.028)+(6.001), (I-749)+(3.028)+(6.002), (I-749)+(3.028)+(6.003), (I-749)+(3.028)+(6.004), (I-749)+(3.028)+(7.001), (I-749)+(3.028)+(7.002), (I-749)+(3.028)+(7.003), (I-749)+(3.028)+(7.004), (I-749)+(3.028)+(7.005), (I-749)+(3.028)+(7.006), (I-749)+(3.028)+(9.001), (I-749)+(3.028)+(9.002), (I-749)+(3.028)+(9.003), (I-749)+(3.028)+(9.004), (I-749)+(3.028)+(9.005), (I-749)+(3.028)+(9.006), (I-749)+(3.028)+(9.007), (I-749)+(3.028)+(9.008), (I-749)+(3.028)+(9.009), (I-749)+(3.028)+(14.001), (I-749)+(3.028)+(14.002), (I-749)+(3.028)+(15.008), (I-749)+(3.028)+(15.011), (I-749)+(3.028)+(15.012), (I-749)+(3.028)+(15.016), (I-749)+(3.028)+(15.025), (I-749)+(3.028)+(15.027), (I-749)+(3.028)+(15.047), (I-749)+(3.028)+(15.063), (I-749)+(3.028)+(15.064), (I-749)+(3.028)+(16.001), (I-749)+(3.028)+(16.002), (I-749)+(3.028)+(16.003), (I-749)+(3.028)+(16.004), (I-749)+(3.028)+(16.005), (I-749)+(3.028)+(16.006), (I-749)+(3.028)+(16.007), (I-749)+(3.028)+(16.008), (I-749)+(3.028)+(17.001), (I-749)+(3.028)+(17.002), (I-749)+(3.028)+(17.003), (I-749)+(3.028)+(17.004), (I-749)+(3.028)+(17.005), (I-749)+(3.028)+(17.006), (I-749)+(3.028)+(17.007), (I-749)+(3.028)+(17.008), (I-749)+(3.028)+(17.009), (I-749)+(3.028)+(17.010), (I-749)+(3.028)+(17.011), (I-749)+(3.028)+(17.012), (I-749)+(3.028)+(18.001),

(I-749)+(3.029)+(3.025), (I-749)+(3.029)+(3.030), (I-749)+(3.029)+(3.031), (I-749)+(3.029)+(5.001), (I-749)+(3.029)+(5.002), (I-749)+(3.029)+(5.003), (I-749)+(3.029)+(5.004), (I-749)+(3.029)+(5.005), (I-749)+(3.029)+(5.006), (I-749)+(3.029)+(5.007), (I-749)+(3.029)+(5.008), (I-749)+(3.029)+(5.009), (I-749)+(3.029)+(5.010), (I-749)+(3.029)+(5.011), (I-749)+(3.029)+(5.012), (I-749)+(3.029)+(5.013), (I-749)+(3.029)+(5.014), (I-749)+(3.029)+(5.015), (I-749)+(3.029)+(5.016), (I-749)+(3.029)+(5.017), (I-749)+(3.029)+(5.018), (I-749)+(3.029)+(5.019), (I-749)+(3.029)+(5.020), (I-749)+(3.029)+(5.021), (I-749)+(3.029)+(5.022), (I-749)+(3.029)+(5.023), (I-749)+(3.029)+(6.001), (I-749)+(3.029)+(6.002), (I-749)+(3.029)+(6.003), (I-749)+(3.029)+(6.004), (I-749)+(3.029)+(7.001), (I-749)+(3.029)+(7.002), (I-749)+(3.029)+(7.003), (I-749)+(3.029)+(7.004), (I-749)+(3.029)+(7.005), (I-749)+(3.029)+(7.006), (I-749)+(3.029)+(9.001), (I-749)+(3.029)+(9.002), (I-749)+(3.029)+(9.003), (I-749)+(3.029)+(9.004), (I-749)+(3.029)+(9.005), (I-749)+(3.029)+(9.006), (I-749)+(3.029)+(9.007), (I-749)+(3.029)+(9.008), (I-749)+(3.029)+(9.009), (I-749)+(3.029)+(14.001), (I-749)+(3.029)+(14.002), (I-749)+(3.029)+(15.008), (I-749)+(3.029)+(15.011), (I-749)+(3.029)+(15.012), (I-749)+(3.029)+(15.016), (I-749)+(3.029)+(15.025), (I-749)+(3.029)+(15.027), (I-749)+(3.029)+(15.047), (I-749)+(3.029)+(15.063), (I-749)+(3.029)+(15.064), (I-749)+(3.029)+(16.001), (I-749)+(3.029)+(16.002), (I-749)+(3.029)+(16.003), (I-749)+(3.029)+(16.004), (I-749)+(3.029)+(16.005), (I-749)+(3.029)+(16.006), (I-749)+(3.029)+(16.007), (I-749)+(3.029)+(16.008), (I-749)+(3.029)+(17.001), (I-749)+(3.029)+(17.002), (I-749)+(3.029)+(17.003), (I-749)+(3.029)+(17.004), (I-749)+(3.029)+(17.005), (I-749)+(3.029)+(17.006), (I-749)+(3.029)+(17.007), (I-749)+(3.029)+(17.008), (I-749)+(3.029)+(17.009), (I-749)+(3.029)+(17.010), (I-749)+(3.029)+(17.011), (I-749)+(3.029)+(17.012), (I-749)+(3.029)+(18.001),

(I-749)+(3.030)+(3.025), (I-749)+(3.030)+(3.031), (I-749)+(3.030)+(5.001), (I-749)+(3.030)+(5.002), (I-749)+(3.030)+(5.003), (I-749)+(3.030)+(5.004), (I-749)+(3.030)+(5.005), (I-749)+(3.030)+(5.006), (I-749)+(3.030)+(5.007), (I-749)+(3.030)+(5.008), (I-749)+(3.030)+(5.009), (I-749)+(3.030)+(5.010), (I-749)+(3.030)+(5.011), (I-749)+(3.030)+(5.012), (I-749)+(3.030)+(5.013), (I-749)+(3.030)+(5.014), (I-749)+(3.030)+(5.015), (I-749)+(3.030)+(5.016), (I-749)+(3.030)+(5.017), (I-749)+(3.030)+(5.018), (I-749)+(3.030)+(5.019), (I-749)+(3.030)+(5.020), (I-749)+(3.030)+(5.021), (I-749)+(3.030)+(5.022), (I-749)+(3.030)+(5.023), (I-749)+(3.030)+(6.001), (I-749)+(3.030)+(6.002), (I-749)+(3.030)+(6.003), (I-749)+(3.030)+(6.004), (I-749)+(3.030)+(7.001), (I-749)+(3.030)+(7.002), (I-749)+(3.030)+(7.003), (I-749)+(3.030)+(7.004), (I-749)+(3.030)+(7.005), (I-749)+(3.030)+(7.006), (I-749)+(3.030)+(9.001), (I-749)+(3.030)+(9.002), (I-749)+(3.030)+(9.003), (I-749)+(3.030)+(9.004), (I-749)+(3.030)+(9.005), (I-749)+(3.030)+(9.006), (I-749)+(3.030)+(9.007), (I-749)+(3.030)+(9.008), (I-749)+(3.030)+(9.009), (I-749)+(3.030)+(14.001), (I-749)+(3.030)+(14.002), (I-749)+(3.030)+(15.008), (I-749)+(3.030)+(15.011), (I-749)+(3.030)+(15.012), (I-749)+(3.030)+(15.016), (I-749)+(3.030)+(15.025), (I-749)+(3.030)+(15.027), (I-749)+(3.030)+(15.047), (I-749)+(3.030)+(15.063), (I-749)+(3.030)+(15.064), (I-749)+(3.030)+(16.001), (I-749)+(3.030)+(16.002), (I-749)+(3.030)+(16.003), (I-749)+(3.030)+(16.004), (I-749)+(3.030)+(16.005), (I-749)+(3.030)+(16.006), (I-749)+(3.030)+(16.007), (I-749)+(3.030)+(16.008), (I-749)+(3.030)+(17.001), (I-749)+(3.030)+(17.002), (I-749)+(3.030)+(17.003), (I-749)+(3.030)+(17.004), (I-749)+(3.030)+(17.005), (I-749)+(3.030)+(17.006), (I-749)+(3.030)+(17.007), (I-749)+(3.030)+(17.008), (I-749)+(3.030)+(17.009), (I-749)+(3.030)+(17.010), (I-749)+(3.030)+(17.011), (I-749)+(3.030)+(17.012), (I-749)+(3.030)+(18.001),

(I-749)+(3.031)+(3.025), (I-749)+(3.031)+(3.030), (I-749)+(3.031)+(5.001), (I-749)+(3.031)+(5.002), (I-749)+(3.031)+(5.003), (I-749)+(3.031)+(5.004), (I-749)+(3.031)+(5.005), (I-749)+(3.031)+(5.006), (I-749)+(3.031)+(5.007), (I-749)+(3.031)+(5.008), (I-749)+(3.031)+(5.009), (I-749)+(3.031)+(5.010), (I-749)+(3.031)+(5.011), (I-749)+(3.031)+(5.012), (I-749)+(3.031)+(5.013), (I-749)+(3.031)+(5.014), (I-749)+(3.031)+(5.015), (I-749)+(3.031)+(5.016), (I-749)+(3.031)+(5.017), (I-749)+(3.031)+(5.018), (I-749)+(3.031)+(5.019), (I-749)+(3.031)+(5.020), (I-749)+(3.031)+(5.021), (I-749)+(3.031)+(5.022), (I-749)+(3.031)+(5.023), (I-749)+(3.031)+(6.001), (I-749)+(3.031)+(6.002), (I-749)+(3.031)+(6.003), (I-749)+(3.031)+(6.004), (I-749)+(3.031)+(7.001), (I-749)+(3.031)+(7.002), (I-749)+(3.031)+(7.003), (I-749)+(3.031)+(7.004), (I-749)+(3.031)+(7.005), (I-749)+(3.031)+(7.006), (I-749)+(3.031)+(9.001), (I-749)+(3.031)+(9.002), (I-749)+(3.031)+(9.003), (I-749)+(3.031)+(9.004), (I-749)+(3.031)+(9.005), (I-749)+(3.031)+(9.006), (I-749)+(3.031)+(9.007), (I-749)+(3.031)+(9.008), (I-749)+(3.031)+(9.009), (I-749)+(3.031)+(14.001), (I-749)+(3.031)+(14.002), (I-749)+(3.031)+(15.008), (I-749)+(3.031)+(15.011), (I-749)+(3.031)+(15.012), (I-749)+(3.031)+(15.016), (I-749)+(3.031)+(15.025), (I-749)+(3.031)+(15.027), (I-749)+(3.031)+(15.047), (I-749)+(3.031)+(15.063), (I-749)+(3.031)+(15.064), (I-749)+(3.031)+(16.001), (I-749)+(3.031)+(16.002), (I-749)+(3.031)+(16.003), (I-749)+(3.031)+(16.004), (I-749)+(3.031)+(16.005), (I-749)+(3.031)+(16.006), (I-749)+(3.031)+(16.007), (I-749)+(3.031)+(16.008), (I-749)+(3.031)+(17.001), (I-749)+(3.031)+(17.002), (I-749)+(3.031)+(17.003), (I-749)+(3.031)+(17.004), (I-749)+(3.031)+(17.005), (I-749)+(3.031)+(17.006), (I-749)+(3.031)+(17.007), (I-749)+(3.031)+(17.008), (I-749)+(3.031)+(17.009), (I-749)+(3.031)+(17.010), (I-749)+(3.031)+(17.011), (I-749)+(3.031)+(17.012), (I-749)+(3.031)+(18.001),

(I-749)+(5.001)+(9.001), (I-749)+(5.001)+(9.002), (I-749)+(5.001)+(9.003), (I-749)+(5.001)+(9.004), (I-749)+(5.001)+(9.005), (I-749)+(5.001)+(9.006), (I-749)+(5.001)+(9.007), (I-749)+(5.001)+(9.008), (I-749)+(5.001)+(9.009), (I-749)+(5.001)+(15.012), (I-749)+(5.001)+(15.016), (I-749)+(5.001)+(15.025), (I-749)+(5.001)+(15.027), (I-749)+(5.001)+(15.047), (I-749)+(5.001)+(15.063), (I-749)+(5.001)+(15.064),

(I-749)+(5.002)+(9.001), (I-749)+(5.002)+(9.002), (I-749)+(5.002)+(9.003), (I-749)+(5.002)+(9.004), (I-749)+(5.002)+(9.005), (I-749)+(5.002)+(9.006), (I-749)+(5.002)+(9.007), (I-749)+(5.002)+(9.008), (I-749)+(5.002)+(9.009), (I-749)+(5.002)+(15.012), (I-749)+(5.002)+(15.016), (I-749)+(5.002)+(15.025), (I-749)+(5.002)+(15.027), (I-749)+(5.002)+(15.047), (I-749)+(5.002)+(15.063), (I-749)+(5.002)+(15.064),

(I-749)+(5.003)+(9.001), (I-749)+(5.003)+(9.002), (I-749)+(5.003)+(9.003), (I-749)+(5.003)+(9.004), (I-749)+(5.003)+(9.005), (I-749)+(5.003)+(9.006), (I-749)+(5.003)+(9.007), (I-749)+(5.003)+(9.008), (I-749)+(5.003)+(9.009), (I-749)+(5.003)+(15.012), (I-749)+(5.003)+(15.016), (I-749)+(5.003)+(15.025), (I-749)+(5.003)+(15.027), (I-749)+(5.003)+(15.047), (I-749)+(5.003)+(15.063), (I-749)+(5.003)+(15.064),

(I-749)+(5.004)+(9.001), (I-749)+(5.004)+(9.002), (I-749)+(5.004)+(9.003), (I-749)+(5.004)+(9.004), (I-749)+(5.004)+(9.005), (I-749)+(5.004)+(9.006), (I-749)+(5.004)+(9.007), (I-749)+(5.004)+(9.008), (I-749)+(5.004)+(9.009), (I-749)+(5.004)+(15.012), (I-749)+(5.004)+(15.016), (I-749)+(5.004)+(15.025), (I-749)+(5.004)+(15.027), (I-749)+(5.004)+(15.047), (I-749)+(5.004)+(15.063), (I-749)+(5.004)+(15.064),

(I-749)+(5.005)+(9.001), (I-749)+(5.005)+(9.002), (I-749)+(5.005)+(9.003), (I-749)+(5.005)+(9.004), (I-749)+(5.005)+(9.005), (I-749)+(5.005)+(9.006), (I-749)+(5.005)+(9.007), (I-749)+(5.005)+(9.008), (I-749)+(5.005)+(9.009), (I-749)+(5.005)+(15.012), (I-749)+(5.005)+(15.016), (I-749)+(5.005)+(15.025), (I-749)+(5.005)+(15.027), (I-749)+(5.005)+(15.047), (I-749)+(5.005)+(15.063), (I-749)+(5.005)+(15.064),

(I-749)+(5.006)+(9.001), (I-749)+(5.006)+(9.002), (I-749)+(5.006)+(9.003), (I-749)+(5.006)+(9.004), (I-749)+(5.006)+(9.005), (I-749)+(5.006)+(9.006), (I-749)+(5.006)+(9.007), (I-749)+(5.006)+(9.008), (I-749)+(5.006)+(9.009), (I-749)+(5.006)+(15.012), (I-749)+(5.006)+(15.016), (I-749)+(5.006)+(15.025), (I-749)+(5.006)+(15.027), (I-749)+(5.006)+(15.047), (I-749)+(5.006)+(15.063), (I-749)+(5.006)+(15.064),

(I-749)+(5.007)+(9.001), (I-749)+(5.007)+(9.002), (I-749)+(5.007)+(9.003), (I-749)+(5.007)+(9.004), (I-749)+(5.007)+(9.005), (I-749)+(5.007)+(9.006), (I-749)+(5.007)+(9.007), (I-749)+(5.007)+(9.008), (I-749)+(5.007)+(9.009), (I-749)+(5.007)+(15.012), (I-749)+(5.007)+(15.016), (I-749)+(5.007)+(15.025), (I-749)+(5.007)+(15.027), (I-749)+(5.007)+(15.047), (I-749)+(5.007)+(15.063), (I-749)+(5.007)+(15.064),

(I-749)+(5.008)+(9.001), (I-749)+(5.008)+(9.002), (I-749)+(5.008)+(9.003), (I-749)+(5.008)+(9.004), (I-749)+(5.008)+(9.005), (I-749)+(5.008)+(9.006), (I-749)+(5.008)+(9.007), (I-749)+(5.008)+(9.008), (I-749)+(5.008)+(9.009), (I-749)+(5.008)+(15.012), (I-749)+(5.008)+(15.016), (I-749)+(5.008)+(15.025), (I-749)+(5.008)+(15.027), (I-749)+(5.008)+(15.047), (I-749)+(5.008)+(15.063), (I-749)+(5.008)+(15.064),

(I-749)+(5.009)+(9.001), (I-749)+(5.009)+(9.002), (I-749)+(5.009)+(9.003), (I-749)+(5.009)+(9.004), (I-749)+(5.009)+(9.005), (I-749)+(5.009)+(9.006), (I-749)+(5.009)+(9.007), (I-749)+(5.009)+(9.008), (I-749)+(5.009)+(9.009), (I-749)+(5.009)+(15.012), (I-749)+(5.009)+(15.016), (I-749)+(5.009)+(15.025), (I-749)+(5.009)+(15.027), (I-749)+(5.009)+(15.047), (I-749)+(5.009)+(15.063), (I-749)+(5.009)+(15.064),

(I-749)+(5.010)+(9.001), (I-749)+(5.010)+(9.002), (I-749)+(5.010)+(9.003), (I-749)+(5.010)+(9.004), (I-749)+(5.010)+(9.005), (I-749)+(5.010)+(9.006), (I-749)+(5.010)+(9.007), (I-749)+(5.010)+(9.008), (I-749)+(5.010)+(9.009), (I-749)+(5.010)+(15.012), (I-749)+(5.010)+(15.016), (I-749)+(5.010)+(15.025), (I-749)+(5.010)+(15.027), (I-749)+(5.010)+(15.047), (I-749)+(5.010)+(15.063), (I-749)+(5.010)+(15.064),

(I-749)+(5.011)+(9.001), (I-749)+(5.011)+(9.002), (I-749)+(5.011)+(9.003), (I-749)+(5.011)+(9.004), (I-749)+(5.011)+(9.005), (I-749)+(5.011)+(9.006), (I-749)+(5.011)+(9.007), (I-749)+(5.011)+(9.008), (I-749)+(5.011)+(9.009), (I-749)+(5.011)+(15.012), (I-749)+(5.011)+(15.016), (I-749)+(5.011)+(15.025), (I-749)+(5.011)+(15.027), (I-749)+(5.011)+(15.047), (I-749)+(5.011)+(15.063), (I-749)+(5.011)+(15.064),

(I-749)+(5.012)+(9.001), (I-749)+(5.012)+(9.002), (I-749)+(5.012)+(9.003), (I-749)+(5.012)+(9.004), (I-749)+(5.012)+(9.005), (I-749)+(5.012)+(9.006), (I-749)+(5.012)+(9.007), (I-749)+(5.012)+(9.008), (I-749)+(5.012)+(9.009), (I-749)+(5.012)+(15.012), (I-749)+(5.012)+(15.016), (I-749)+(5.012)+(15.025), (I-749)+(5.012)+(15.027), (I-749)+(5.012)+(15.047), (I-749)+(5.012)+(15.063), (I-749)+(5.012)+(15.064),

(I-749)+(5.013)+(9.001), (I-749)+(5.013)+(9.002), (I-749)+(5.013)+(9.003), (I-749)+(5.013)+(9.004), (I-749)+(5.013)+(9.005), (I-749)+(5.013)+(9.006), (I-749)+(5.013)+(9.007), (I-749)+(5.013)+(9.008), (I-749)+(5.013)+(9.009), (I-749)+(5.013)+(15.012), (I-749)+(5.013)+(15.016), (I-749)+(5.013)+(15.025), (I-749)+(5.013)+(15.027), (I-749)+(5.013)+(15.047), (I-749)+(5.013)+(15.063), (I-749)+(5.013)+(15.064),

(I-749)+(5.014)+(9.001), (I-749)+(5.014)+(9.002), (I-749)+(5.014)+(9.003), (I-749)+(5.014)+(9.004), (I-749)+(5.014)+(9.005), (I-749)+(5.014)+(9.006), (I-749)+(5.014)+(9.007), (I-749)+(5.014)+(9.008), (I-749)+(5.014)+(9.009), (I-749)+(5.014)+(15.012), (I-749)+(5.014)+(15.016), (I-749)+(5.014)+(15.025), (I-749)+(5.014)+(15.027), (I-749)+(5.014)+(15.047), (I-749)+(5.014)+(15.063), (I-749)+(5.014)+(15.064),

(I-749)+(5.015)+(9.001), (I-749)+(5.015)+(9.002), (I-749)+(5.015)+(9.003), (I-749)+(5.015)+(9.004), (I-749)+(5.015)+(9.005), (I-749)+(5.015)+(9.006), (I-749)+(5.015)+(9.007), (I-749)+(5.015)+(9.008), (I-749)+(5.015)+(9.009), (I-749)+(5.015)+(15.012), (I-749)+(5.015)+(15.016), (I-749)+(5.015)+(15.025), (I-749)+(5.015)+(15.027), (I-749)+(5.015)+(15.047), (I-749)+(5.015)+(15.063), (I-749)+(5.015)+(15.064),

(I-749)+(5.016)+(9.001), (I-749)+(5.016)+(9.002), (I-749)+(5.016)+(9.003), (I-749)+(5.016)+(9.004), (I-749)+(5.016)+(9.005), (I-749)+(5.016)+(9.006), (I-749)+(5.016)+(9.007), (I-749)+(5.016)+(9.008), (I-749)+(5.016)+(9.009), (I-749)+(5.016)+(15.012), (I-749)+(5.016)+(15.016), (I-749)+(5.016)+(15.025), (I-749)+(5.016)+(15.027), (I-749)+(5.016)+(15.047), (I-749)+(5.016)+(15.063), (I-749)+(5.016)+(15.064),

(I-749)+(5.017)+(9.001), (I-749)+(5.017)+(9.002), (I-749)+(5.017)+(9.003), (I-749)+(5.017)+(9.004), (I-749)+(5.017)+(9.005), (I-749)+(5.017)+(9.006), (I-749)+(5.017)+(9.007), (I-749)+(5.017)+(9.008), (I-749)+(5.017)+(9.009), (I-749)+(5.017)+(15.012), (I-749)+(5.017)+(15.016), (I-749)+(5.017)+(15.025), (I-749)+(5.017)+(15.027), (I-749)+(5.017)+(15.047), (I-749)+(5.017)+(15.063), (I-749)+(5.017)+(15.064),

(I-749)+(5.018)+(9.001), (I-749)+(5.018)+(9.002), (I-749)+(5.018)+(9.003), (I-749)+(5.018)+(9.004), (I-749)+(5.018)+(9.005), (I-749)+(5.018)+(9.006), (I-749)+(5.018)+(9.007), (I-749)+(5.018)+(9.008), (I-749)+(5.018)+(9.009), (I-749)+(5.018)+(15.012), (I-749)+(5.018)+(15.016), (I-749)+(5.018)+(15.025), (I-749)+(5.018)+(15.027), (I-749)+(5.018)+(15.047), (I-749)+(5.018)+(15.063), (I-749)+(5.018)+(15.064),

(I-749)+(5.019)+(9.001), (I-749)+(5.019)+(9.002), (I-749)+(5.019)+(9.003), (I-749)+(5.019)+(9.004), (I-749)+(5.019)+(9.005), (I-749)+(5.019)+(9.006), (I-749)+(5.019)+(9.007), (I-749)+(5.019)+(9.008), (I-749)+(5.019)+(9.009), (I-749)+(5.019)+(15.012), (I-749)+(5.019)+(15.016), (I-749)+(5.019)+(15.025), (I-749)+(5.019)+(15.027), (I-749)+(5.019)+(15.047), (I-749)+(5.019)+(15.063), (I-749)+(5.019)+(15.064),

(I-749)+(5.020)+(9.001), (I-749)+(5.020)+(9.002), (I-749)+(5.020)+(9.003), (I-749)+(5.020)+(9.004), (I-749)+(5.020)+(9.005), (I-749)+(5.020)+(9.006), (I-749)+(5.020)+(9.007), (I-749)+(5.020)+(9.008), (I-749)+(5.020)+(9.009), (I-749)+(5.020)+(15.012), (I-749)+(5.020)+(15.016), (I-749)+(5.020)+(15.025), (I-749)+(5.020)+(15.027), (I-749)+(5.020)+(15.047), (I-749)+(5.020)+(15.063), (I-749)+(5.020)+(15.064),

(I-749)+(5.021)+(9.001), (I-749)+(5.021)+(9.002), (I-749)+(5.021)+(9.003), (I-749)+(5.021)+(9.004), (I-749)+(5.021)+(9.005), (I-749)+(5.021)+(9.006), (I-749)+(5.021)+(9.007), (I-749)+(5.021)+(9.008), (I-749)+(5.021)+(9.009), (I-749)+(5.021)+(15.012), (I-749)+(5.021)+(15.016), (I-749)+(5.021)+(15.025), (I-749)+(5.021)+(15.027), (I-749)+(5.021)+(15.047), (I-749)+(5.021)+(15.063), (I-749)+(5.021)+(15.064),

(I-749)+(5.022)+(9.001), (I-749)+(5.022)+(9.002), (I-749)+(5.022)+(9.003), (I-749)+(5.022)+(9.004), (I-749)+(5.022)+(9.005), (I-749)+(5.022)+(9.006), (I-749)+(5.022)+(9.007), (I-749)+(5.022)+(9.008), (I-749)+(5.022)+(9.009), (I-749)+(5.022)+(15.012), (I-749)+(5.022)+(15.016), (I-749)+(5.022)+(15.025), (I-749)+(5.022)+(15.027), (I-749)+(5.022)+(15.047), (I-749)+(5.022)+(15.063), (I-749)+(5.022)+(15.064),

(I-749)+(5.023)+(9.001), (I-749)+(5.023)+(9.002), (I-749)+(5.023)+(9.003), (I-749)+(5.023)+(9.004), (I-749)+(5.023)+(9.005), (I-749)+(5.023)+(9.006), (I-749)+(5.023)+(9.007), (I-749)+(5.023)+(9.008), (I-749)+(5.023)+(9.009), (I-749)+(5.023)+(15.012), (I-749)+(5.023)+(15.016), (I-749)+(5.023)+(15.025), (I-749)+(5.023)+(15.027), (I-749)+(5.023)+(15.047), (I-749)+(5.023)+(15.063), (I-749)+(5.023)+(15.064).

If two compounds (B) are present in the combinations according to the invention, more preferred compound combinations are selected from the group (G1-C1) consisting of the following mixtures:

(I-655)+(1.001)+(1.002), (I-655)+(1.001)+(1.003), (I-655)+(1.001)+(1.004), (I-655)+(1.001)+(1.005), (I-655)+(1.001)+(1.006), (I-655)+(1.001)+(1.007), (I-655)+(1.001)+(1.010), (I-655)+(1.001)+(1.011), (I-655)+(1.001)+(1.012), (I-655)+(1.001)+(1.013), (I-655)+(1.001)+(1.017), (I-655)+(1.001)+(1.018), (I-655)+(1.001)+(1.020), (I-655)+(1.001)+(1.021), (I-655)+(1.001)+(1.026), (I-655)+(1.001)+(1.027), (I-655)+(1.001)+(1.055), (I-655)+(1.001)+(1.059), (I-655)+(1.001)+(1.092), (I-655)+(1.001)+(2.001), (I-655)+(1.001)+(2.002), (I-655)+(1.001)+(2.003), (I-655)+(1.001)+(2.005), (I-655)+(1.001)+(2.007), (I-655)+(1.001)+(2.009), (I-655)+(1.001)+(2.010), (I-655)+(1.001)+(2.011), (I-655)+(1.001)+(2.012), (I-655)+(1.001)+(2.013), (I-655)+(1.001)+(2.014), (I-655)+(1.001)+(2.015), (I-655)+(1.001)+(2.016), (I-655)+(1.001)+(2.017), (I-655)+(1.001)+(2.018), (I-655)+(1.001)+(2.019), (I-655)+(1.001)+(2.021), (I-655)+(1.001)+(2.028), (I-655)+(1.001)+(2.030), (I-655)+(1.001)+(2.038), (I-655)+(1.001)+(3.003), (I-655)+(1.001)+(3.007), (I-655)+(1.001)+(3.012), (I-655)+(1.001)+(3.013), (I-655)+(1.001)+(3.016), (I-655)+(1.001)+(3.017), (I-655)+(1.001)+(3.020), (I-655)+(1.001)+(3.025), (I-655)+(1.001)+(3.026), (I-655)+(1.001)+(3.030), (I-655)+(1.001)+(3.031), (I-655)+(1.001)+(5.003), (I-655)+(1.001)+(5.004), (I-655)+(1.001)+(5.005), (I-655)+(1.001)+(5.008), (I-655)+(1.001)+(5.009), (I-655)+(1.001)+(5.011), (I-655)+(1.001)+(5.012), (I-655)+(1.001)+(5.013), (I-655)+(1.001)+(5.015), (I-655)+(1.001)+(5.018), (I-655)+(1.001)+(5.019), (I-655)+(1.001)+(6.002), (I-655)+(1.001)+(7.001), (I-655)+(1.001)+(7.005), (I-655)+(1.001)+(9.002), (I-655)+(1.001)+(9.004), (I-655)+(1.001)+(14.001), (I-655)+(1.001)+(14.002), (I-655)+(1.001)+(15.008), (I-655)+(1.001)+(15.011), (I-655)+(1.001)+(15.012), (I-655)+(1.001)+(15.016), (I-655)+(1.001)+(15.025), (I-655)+(1.001)+(15.027), (I-655)+(1.001)+(15.047), (I-655)+(1.001)+(15.063), (I-655)+(1.001)+(15.064), (I-655)+(1.001)+(16.001), (I-655)+(1.001)+(16.005), (I-655)+(1.001)+(17.001), (I-655)+(1.001)+(17.002), (I-655)+(1.001)+(17.003), (I-655)+(1.001)+(17.008), (I-655)+(1.001)+(18.001),

(I-655)+(1.002)+(1.001), (I-655)+(1.002)+(1.003), (I-655)+(1.002)+(1.004), (I-655)+(1.002)+(1.005), (I-655)+(1.002)+(1.006), (I-655)+(1.002)+(1.007), (I-655)+(1.002)+(1.010), (I-655)+(1.002)+(1.011), (I-655)+(1.002)+(1.012), (I-655)+(1.002)+(1.013), (I-655)+(1.002)+(1.017), (I-655)+(1.002)+(1.018), (I-655)+(1.002)+(1.020), (I-655)+(1.002)+(1.021), (I-655)+(1.002)+(1.026), (I-655)+(1.002)+(1.027), (I-655)+(1.002)+(1.055), (I-655)+(1.002)+(1.059), (I-655)+(1.002)+(1.092), (I-655)+(1.002)+(2.001), (I-655)+(1.002)+(2.002), (I-655)+(1.002)+(2.003), (I-655)+(1.002)+(2.005), (I-655)+(1.002)+(2.007), (I-655)+(1.002)+(2.009), (I-655)+(1.002)+(2.010), (I-655)+(1.002)+(2.011), (I-655)+(1.002)+(2.012), (I-655)+(1.002)+(2.013), (I-655)+(1.002)+(2.014), (I-655)+(1.002)+(2.015), (I-655)+(1.002)+(2.016), (I-655)+(1.002)+(2.017), (I-655)+(1.002)+(2.018), (I-655)+(1.002)+(2.019), (I-655)+(1.002)+(2.021), (I-655)+(1.002)+(2.028), (I-655)+(1.002)+(2.030), (I-655)+(1.002)+(2.038), (I-655)+(1.002)+(3.003), (I-655)+(1.002)+(3.007), (I-655)+(1.002)+(3.012), (I-655)+(1.002)+(3.013), (I-655)+(1.002)+(3.016), (I-655)+(1.002)+(3.017), (I-655)+(1.002)+(3.020), (I-655)+(1.002)+(3.025), (I-655)+(1.002)+(3.026), (I-655)+(1.002)+(3.030), (I-655)+(1.002)+(3.031), (I-655)+(1.002)+(5.003), (I-655)+(1.002)+(5.004), (I-655)+(1.002)+(5.005), (I-655)+(1.002)+(5.008), (I-655)+(1.002)+(5.009), (I-655)+(1.002)+(5.011), (I-655)+(1.002)+(5.012), (I-655)+(1.002)+(5.013), (I-655)+(1.002)+(5.015), (I-655)+(1.002)+(5.018), (I-655)+(1.002)+(5.019), (I-655)+(1.002)+(6.002), (I-655)+(1.002)+(7.001), (I-655)+(1.002)+(7.005), (I-655)+(1.002)+(9.002), (I-655)+(1.002)+(9.004), (I-655)+(1.002)+(14.001), (I-655)+(1.002)+(14.002), (I-655)+(1.002)+(15.008), (I-655)+(1.002)+(15.011), (I-655)+(1.002)+(15.012), (I-655)+(1.002)+(15.016), (I-655)+(1.002)+(15.025), (I-655)+(1.002)+(15.027), (I-655)+(1.002)+(15.047), (I-655)+(1.002)+(15.063), (I-655)+(1.002)+(15.064), (I-655)+(1.002)+(16.001), (I-655)+(1.002)+(16.005), (I-655)+(1.002)+(17.001), (I-655)+(1.002)+(17.002), (I-655)+(1.002)+(17.003), (I-655)+(1.002)+(17.008), (I-655)+(1.002)+(18.001),

(I-655)+(1.003)+(1.001), (I-655)+(1.003)+(1.002), (I-655)+(1.003)+(1.004), (I-655)+(1.003)+(1.005), (I-655)+(1.003)+(1.006), (I-655)+(1.003)+(1.007), (I-655)+(1.003)+(1.010), (I-655)+(1.003)+(1.011), (I-655)+(1.003)+(1.012), (I-655)+(1.003)+(1.013), (I-655)+(1.003)+(1.017), (I-655)+(1.003)+(1.018), (I-655)+(1.003)+(1.020), (I-655)+(1.003)+(1.021), (I-655)+(1.003)+(1.026), (I-655)+(1.003)+(1.027), (I-655)+(1.003)+(1.055), (I-655)+(1.003)+(1.059), (I-655)+(1.003)+(1.092), (I-655)+(1.003)+(2.001), (I-655)+(1.003)+(2.002), (I-655)+(1.003)+(2.003), (I-655)+(1.003)+(2.005), (I-655)+(1.003)+(2.007), (I-655)+(1.003)+(2.009), (I-655)+(1.003)+(2.010), (I-655)+(1.003)+(2.011), (I-655)+(1.003)+(2.012), (I-655)+(1.003)+(2.013), (I-655)+(1.003)+(2.014), (I-655)+(1.003)+(2.015), (I-655)+(1.003)+(2.016), (I-655)+(1.003)+(2.017), (I-655)+(1.003)+(2.018), (I-655)+(1.003)+(2.019), (I-655)+(1.003)+(2.021), (I-655)+(1.003)+(2.028), (I-655)+(1.003)+(2.030), (I-655)+(1.003)+(2.038), (I-655)+(1.003)+(3.003), (I-655)+(1.003)+(3.007), (I-655)+(1.003)+(3.012), (I-655)+(1.003)+(3.013), (I-655)+(1.003)+(3.016), (I-655)+(1.003)+(3.017), (I-655)+(1.003)+(3.020), (I-655)+(1.003)+(3.025), (I-655)+(1.003)+(3.026), (I-655)+(1.003)+(3.030), (I-655)+(1.003)+(3.031), (I-655)+(1.003)+(5.003), (I-655)+(1.003)+(5.004), (I-655)+(1.003)+(5.005), (I-655)+(1.003)+(5.008), (I-655)+(1.003)+(5.009), (I-655)+(1.003)+(5.011), (I-655)+(1.003)+(5.012), (I-655)+(1.003)+(5.013), (I-655)+(1.003)+(5.015), (I-655)+(1.003)+(5.018), (I-655)+(1.003)+(5.019), (I-655)+(1.003)+(6.002), (I-655)+(1.003)+(7.001), (I-655)+(1.003)+(7.005), (I-655)+(1.003)+(9.002), (I-655)+(1.003)+(9.004), (I-655)+(1.003)+(14.001), (I-655)+(1.003)+(14.002), (I-655)+(1.003)+(15.008), (I-655)+(1.003)+(15.011), (I-655)+(1.003)+(15.012), (I-655)+(1.003)+(15.016), (I-655)+(1.003)+(15.025), (I-655)+(1.003)+(15.027), (I-655)+(1.003)+(15.047), (I-655)+(1.003)+(15.063), (I-655)+(1.003)+(15.064), (I-655)+(1.003)+(16.001), (I-655)+(1.003)+(16.005), (I-655)+(1.003)+(17.001), (I-655)+(1.003)+(17.002), (I-655)+(1.003)+(17.003), (I-655)+(1.003)+(17.008), (I-655)+(1.003)+(18.001),

(I-655)+(1.004)+(1.001), (I-655)+(1.004)+(1.002), (I-655)+(1.004)+(1.003), (I-655)+(1.004)+(1.005), (I-655)+(1.004)+(1.006), (I-655)+(1.004)+(1.007), (I-655)+(1.004)+(1.010), (I-655)+(1.004)+(1.011), (I-655)+(1.004)+(1.012), (I-655)+(1.004)+(1.013), (I-655)+(1.004)+(1.017), (I-655)+(1.004)+(1.018), (I-655)+(1.004)+(1.020), (I-655)+(1.004)+(1.021), (I-655)+(1.004)+(1.026), (I-655)+(1.004)+(1.027), (I-655)+(1.004)+(1.055), (I-655)+(1.004)+(1.059), (I-655)+(1.004)+(1.092), (I-655)+(1.004)+(2.001), (I-655)+(1.004)+(2.002), (I-655)+(1.004)+(2.003), (I-655)+(1.004)+(2.005), (I-655)+(1.004)+(2.007), (I-655)+(1.004)+(2.009), (I-655)+(1.004)+(2.010), (I-655)+(1.004)+(2.011), (I-655)+(1.004)+(2.012), (I-655)+(1.004)+(2.013), (I-655)+(1.004)+(2.014), (I-655)+(1.004)+(2.015), (I-655)+(1.004)+(2.016), (I-655)+(1.004)+(2.017), (I-655)+(1.004)+(2.018), (I-655)+(1.004)+(2.019), (I-655)+(1.004)+(2.021), (I-655)+(1.004)+(2.028), (I-655)+(1.004)+(2.030), (I-655)+(1.004)+(2.038), (I-655)+(1.004)+(3.003), (I-655)+(1.004)+(3.007), (I-655)+(1.004)+(3.012), (I-655)+(1.004)+(3.013), (I-655)+(1.004)+(3.016), (I-655)+(1.004)+(3.017), (I-655)+(1.004)+(3.020), (I-655)+(1.004)+(3.025), (I-655)+(1.004)+(3.026), (I-655)+(1.004)+(3.030), (I-655)+(1.004)+(3.031), (I-655)+(1.004)+(5.003), (I-655)+(1.004)+(5.004), (I-655)+(1.004)+(5.005), (I-655)+(1.004)+(5.008), (I-655)+(1.004)+(5.009), (I-655)+(1.004)+(5.011), (I-655)+(1.004)+(5.012), (I-655)+(1.004)+(5.013), (I-655)+(1.004)+(5.015), (I-655)+(1.004)+(5.018), (I-655)+(1.004)+(5.019), (I-655)+(1.004)+(6.002), (I-655)+(1.004)+(7.001), (I-655)+(1.004)+(7.005), (I-655)+(1.004)+(9.002), (I-655)+(1.004)+(9.004), (I-655)+(1.004)+(14.001), (I-655)+(1.004)+(14.002), (I-655)+(1.004)+(15.008), (I-655)+(1.004)+(15.011), (I-655)+(1.004)+(15.012), (I-655)+(1.004)+(15.016), (I-655)+(1.004)+(15.025), (I-655)+(1.004)+(15.027), (I-655)+(1.004)+(15.047), (I-655)+(1.004)+(15.063), (I-655)+(1.004)+(15.064), (I-655)+(1.004)+(16.001), (I-655)+(1.004)+(16.005), (I-655)+(1.004)+(17.001), (I-655)+(1.004)+(17.002), (I-655)+(1.004)+(17.003), (I-655)+(1.004)+(17.008), (I-655)+(1.004)+(18.001),

(I-655)+(1.005)+(1.001), (I-655)+(1.005)+(1.002), (I-655)+(1.005)+(1.003), (I-655)+(1.005)+(1.004), (I-655)+(1.005)+(1.006), (I-655)+(1.005)+(1.007), (I-655)+(1.005)+(1.010), (I-655)+(1.005)+(1.011), (I-655)+(1.005)+(1.012), (I-655)+(1.005)+(1.013), (I-655)+(1.005)+(1.017), (I-655)+(1.005)+(1.018), (I-655)+(1.005)+(1.020), (I-655)+(1.005)+(1.021), (I-655)+(1.005)+(1.026), (I-655)+(1.005)+(1.027), (I-655)+(1.005)+(1.055), (I-655)+(1.005)+(1.059), (I-655)+(1.005)+(1.092), (I-655)+(1.005)+(2.001), (I-655)+(1.005)+(2.002), (I-655)+(1.005)+(2.003), (I-655)+(1.005)+(2.005), (I-655)+(1.005)+(2.007), (I-655)+(1.005)+(2.009), (I-655)+(1.005)+(2.010), (I-655)+(1.005)+(2.011), (I-655)+(1.005)+(2.012), (I-655)+(1.005)+(2.013), (I-655)+(1.005)+(2.014), (I-655)+(1.005)+(2.015), (I-655)+(1.005)+(2.016), (I-655)+(1.005)+(2.017), (I-655)+(1.005)+(2.018), (I-655)+(1.005)+(2.019), (I-655)+(1.005)+(2.021), (I-655)+(1.005)+(2.028), (I-655)+(1.005)+(2.030), (I-655)+(1.005)+(2.038), (I-655)+(1.005)+(3.003), (I-655)+(1.005)+(3.007), (I-655)+(1.005)+(3.012), (I-655)+(1.005)+(3.013), (I-655)+(1.005)+(3.016), (I-655)+(1.005)+(3.017), (I-655)+(1.005)+(3.020), (I-655)+(1.005)+(3.025), (I-655)+(1.005)+(3.026), (I-655)+(1.005)+(3.030), (I-655)+(1.005)+(3.031), (I-655)+(1.005)+(5.003), (I-655)+(1.005)+(5.004), (I-655)+(1.005)+(5.005), (I-655)+(1.005)+(5.008), (I-655)+(1.005)+(5.009), (I-655)+(1.005)+(5.011), (I-655)+(1.005)+(5.012), (I-655)+(1.005)+(5.013), (I-655)+(1.005)+(5.015), (I-655)+(1.005)+(5.018), (I-655)+(1.005)+(5.019), (I-655)+(1.005)+(6.002), (I-655)+(1.005)+(7.001), (I-655)+(1.005)+(7.005), (I-655)+(1.005)+(9.002), (I-655)+(1.005)+(9.004), (I-655)+(1.005)+(14.001), (I-655)+(1.005)+(14.002), (I-655)+(1.005)+(15.008), (I-655)+(1.005)+(15.011), (I-655)+(1.005)+(15.012), (I-655)+(1.005)+(15.016), (I-655)+(1.005)+(15.025), (I-655)+(1.005)+(15.027), (I-655)+(1.005)+(15.047), (I-655)+(1.005)+(15.063), (I-655)+(1.005)+(15.064), (I-655)+(1.005)+(16.001), (I-655)+(1.005)+(16.005), (I-655)+(1.005)+(17.001), (I-655)+(1.005)+(17.002), (I-655)+(1.005)+(17.003), (I-655)+(1.005)+(17.008), (I-655)+(1.005)+(18.001),

(I-655)+(1.006)+(1.001), (I-655)+(1.006)+(1.002), (I-655)+(1.006)+(1.003), (I-655)+(1.006)+(1.004), (I-655)+(1.006)+(1.005), (I-655)+(1.006)+(1.007), (I-655)+(1.006)+(1.010), (I-655)+(1.006)+(1.011), (I-655)+(1.006)+(1.012), (I-655)+(1.006)+(1.013), (I-655)+(1.006)+(1.017), (I-655)+(1.006)+(1.018), (I-655)+(1.006)+(1.020), (I-655)+(1.006)+(1.021), (I-655)+(1.006)+(1.026), (I-655)+(1.006)+(1.027), (I-655)+(1.006)+(1.055), (I-655)+(1.006)+(1.059), (I-655)+(1.006)+(1.092), (I-655)+(1.006)+(2.001), (I-655)+(1.006)+(2.002), (I-655)+(1.006)+(2.003), (I-655)+(1.006)+(2.005), (I-655)+(1.006)+(2.007), (I-655)+(1.006)+(2.009), (I-655)+(1.006)+(2.010), (I-655)+(1.006)+(2.011), (I-655)+(1.006)+(2.012), (I-655)+(1.006)+(2.013), (I-655)+(1.006)+(2.014), (I-655)+(1.006)+(2.015), (I-655)+(1.006)+(2.016), (I-655)+(1.006)+(2.017), (I-655)+(1.006)+(2.018), (I-655)+(1.006)+(2.019), (I-655)+(1.006)+(2.021), (I-655)+(1.006)+(2.028), (I-655)+(1.006)+(2.030), (I-655)+(1.006)+(2.038), (I-655)+(1.006)+(3.003), (I-655)+(1.006)+(3.007), (I-655)+(1.006)+(3.012), (I-655)+(1.006)+(3.013), (I-655)+(1.006)+(3.016), (I-655)+(1.006)+(3.017), (I-655)+(1.006)+(3.020), (I-655)+(1.006)+(3.025), (I-655)+(1.006)+(3.026), (I-655)+(1.006)+(3.030), (I-655)+(1.006)+(3.031), (I-655)+(1.006)+(5.003), (I-655)+(1.006)+(5.004), (I-655)+(1.006)+(5.005), (I-655)+(1.006)+(5.008), (I-655)+(1.006)+(5.009), (I-655)+(1.006)+(5.011), (I-655)+(1.006)+(5.012), (I-655)+(1.006)+(5.013), (I-655)+(1.006)+(5.015), (I-655)+(1.006)+(5.018), (I-655)+(1.006)+(5.019), (I-655)+(1.006)+(6.002), (I-655)+(1.006)+(7.001), (I-655)+(1.006)+(7.005), (I-655)+(1.006)+(9.002), (I-655)+(1.006)+(9.004), (I-655)+(1.006)+(14.001), (I-655)+(1.006)+(14.002), (I-655)+(1.006)+(15.008), (I-655)+(1.006)+(15.011), (I-655)+(1.006)+(15.012), (I-655)+(1.006)+(15.016), (I-655)+(1.006)+(15.025), (I-655)+(1.006)+(15.027), (I-655)+(1.006)+(15.047), (I-655)+(1.006)+(15.063), (I-655)+(1.006)+(15.064), (I-655)+(1.006)+(16.001), (I-655)+(1.006)+(16.005), (I-655)+(1.006)+(17.001), (I-655)+(1.006)+(17.002), (I-655)+(1.006)+(17.003), (I-655)+(1.006)+(17.008), (I-655)+(1.006)+(18.001),

(I-655)+(1.007)+(1.001), (I-655)+(1.007)+(1.002), (I-655)+(1.007)+(1.003), (I-655)+(1.007)+(1.004), (I-655)+(1.007)+(1.005), (I-655)+(1.007)+(1.006), (I-655)+(1.007)+(1.010), (I-655)+(1.007)+(1.011), (I-655)+(1.007)+(1.012), (I-655)+(1.007)+(1.013), (I-655)+(1.007)+(1.017), (I-655)+(1.007)+(1.018), (I-655)+(1.007)+(1.020), (I-655)+(1.007)+(1.021), (I-655)+(1.007)+(1.026), (I-655)+(1.007)+(1.027), (I-655)+(1.007)+(1.055), (I-655)+(1.007)+(1.059), (I-655)+(1.007)+(1.092), (I-655)+(1.007)+(2.001), (I-655)+(1.007)+(2.002), (I-655)+(1.007)+(2.003), (I-655)+(1.007)+(2.005), (I-655)+(1.007)+(2.007), (I-655)+(1.007)+(2.009), (I-655)+(1.007)+(2.010), (I-655)+(1.007)+(2.011), (I-655)+(1.007)+(2.012), (I-655)+(1.007)+(2.013), (I-655)+(1.007)+(2.014), (I-655)+(1.007)+(2.015), (I-655)+(1.007)+(2.016), (I-655)+(1.007)+(2.017), (I-655)+(1.007)+(2.018), (I-655)+(1.007)+(2.019), (I-655)+(1.007)+(2.021), (I-655)+(1.007)+(2.028), (I-655)+(1.007)+(2.030), (I-655)+(1.007)+(2.038), (I-655)+(1.007)+(3.003), (I-655)+(1.007)+(3.007), (I-655)+(1.007)+(3.012), (I-655)+(1.007)+(3.013), (I-655)+(1.007)+(3.016), (I-655)+(1.007)+(3.017), (I-655)+(1.007)+(3.020), (I-655)+(1.007)+(3.025), (I-655)+(1.007)+(3.026), (I-655)+(1.007)+(3.030), (I-655)+(1.007)+(3.031), (I-655)+(1.007)+(5.003), (I-655)+(1.007)+(5.004), (I-655)+(1.007)+(5.005), (I-655)+(1.007)+(5.008), (I-655)+(1.007)+(5.009), (I-655)+(1.007)+(5.011), (I-655)+(1.007)+(5.012), (I-655)+(1.007)+(5.013), (I-655)+(1.007)+(5.015), (I-655)+(1.007)+(5.018), (I-655)+(1.007)+(5.019), (I-655)+(1.007)+(6.002), (I-655)+(1.007)+(7.001), (I-655)+(1.007)+(7.005), (I-655)+(1.007)+(9.002), (I-655)+(1.007)+(9.004), (I-655)+(1.007)+(14.001), (I-655)+(1.007)+(14.002), (I-655)+(1.007)+(15.008), (I-655)+(1.007)+(15.011), (I-655)+(1.007)+(15.012), (I-655)+(1.007)+(15.016), (I-655)+(1.007)+(15.025), (I-655)+(1.007)+(15.027), (I-655)+(1.007)+(15.047), (I-655)+(1.007)+(15.063), (I-655)+(1.007)+(15.064), (I-655)+(1.007)+(16.001), (I-655)+(1.007)+(16.005), (I-655)+(1.007)+(17.001), (I-655)+(1.007)+(17.002), (I-655)+(1.007)+(17.003), (I-655)+(1.007)+(17.008), (I-655)+(1.007)+(18.001),

(I-655)+(1.010)+(1.001), (I-655)+(1.010)+(1.002), (I-655)+(1.010)+(1.003), (I-655)+(1.010)+(1.004), (I-655)+(1.010)+(1.005), (I-655)+(1.010)+(1.006), (I-655)+(1.010)+(1.007), (I-655)+(1.010)+(1.011), (I-655)+(1.010)+(1.012), (I-655)+(1.010)+(1.013), (I-655)+(1.010)+(1.017), (I-655)+(1.010)+(1.018), (I-655)+(1.010)+(1.020), (I-655)+(1.010)+(1.021), (I-655)+(1.010)+(1.026), (I-655)+(1.010)+(1.027), (I-655)+(1.010)+(1.055), (I-655)+(1.010)+(1.059), (I-655)+(1.010)+(1.092), (I-655)+(1.010)+(2.001), (I-655)+(1.010)+(2.002), (I-655)+(1.010)+(2.003), (I-655)+(1.010)+(2.005), (I-655)+(1.010)+(2.007), (I-655)+(1.010)+(2.009), (I-655)+(1.010)+(2.010), (I-655)+(1.010)+(2.011), (I-655)+(1.010)+(2.012), (I-655)+(1.010)+(2.013), (I-655)+(1.010)+(2.014), (I-655)+(1.010)+(2.015), (I-655)+(1.010)+(2.016), (I-655)+(1.010)+(2.017), (I-655)+(1.010)+(2.018), (I-655)+(1.010)+(2.019), (I-655)+(1.010)+(2.021), (I-655)+(1.010)+(2.028), (I-655)+(1.010)+(2.030), (I-655)+(1.010)+(2.038), (I-655)+(1.010)+(3.003), (I-655)+(1.010)+(3.007), (I-655)+(1.010)+(3.012), (I-655)+(1.010)+(3.013), (I-655)+(1.010)+(3.016), (I-655)+(1.010)+(3.017), (I-655)+(1.010)+(3.020), (I-655)+(1.010)+(3.025), (I-655)+(1.010)+(3.026), (I-655)+(1.010)+(3.030), (I-655)+(1.010)+(3.031), (I-655)+(1.010)+(5.003), (I-655)+(1.010)+(5.004), (I-655)+(1.010)+(5.005), (I-655)+(1.010)+(5.008), (I-655)+(1.010)+(5.009), (I-655)+(1.010)+(5.011), (I-655)+(1.010)+(5.012), (I-655)+(1.010)+(5.013), (I-655)+(1.010)+(5.015), (I-655)+(1.010)+(5.018), (I-655)+(1.010)+(5.019), (I-655)+(1.010)+(6.002), (I-655)+(1.010)+(7.001), (I-655)+(1.010)+(7.005), (I-655)+(1.010)+(9.002), (I-655)+(1.010)+(9.004), (I-655)+(1.010)+(14.001), (I-655)+(1.010)+(14.002), (I-655)+(1.010)+(15.008), (I-655)+(1.010)+(15.011), (I-655)+(1.010)+(15.012), (I-655)+(1.010)+(15.016), (I-655)+(1.010)+(15.025), (I-655)+(1.010)+(15.027), (I-655)+(1.010)+(15.047), (I-655)+(1.010)+(15.063), (I-655)+(1.010)+(15.064), (I-655)+(1.010)+(16.001), (I-655)+(1.010)+(16.005), (I-655)+(1.010)+(17.001), (I-655)+(1.010)+(17.002), (I-655)+(1.010)+(17.003), (I-655)+(1.010)+(17.008), (I-655)+(1.010)+(18.001),

(I-655)+(1.011)+(1.001), (I-655)+(1.011)+(1.002), (I-655)+(1.011)+(1.003), (I-655)+(1.011)+(1.004), (I-655)+(1.011)+(1.005), (I-655)+(1.011)+(1.006), (I-655)+(1.011)+(1.007), (I-655)+(1.011)+(1.010), (I-655)+(1.011)+(1.012), (I-655)+(1.011)+(1.013), (I-655)+(1.011)+(1.017), (I-655)+(1.011)+(1.018), (I-655)+(1.011)+(1.020), (I-655)+(1.011)+(1.021), (I-655)+(1.011)+(1.026), (I-655)+(1.011)+(1.027), (I-655)+(1.011)+(1.055), (I-655)+(1.011)+(1.059), (I-655)+(1.011)+(1.092), (I-655)+(1.011)+(2.001), (I-655)+(1.011)+(2.002), (I-655)+(1.011)+(2.003), (I-655)+(1.011)+(2.005), (I-655)+(1.011)+(2.007), (I-655)+(1.011)+(2.009), (I-655)+(1.011)+(2.010), (I-655)+(1.011)+(2.011), (I-655)+(1.011)+(2.012), (I-655)+(1.011)+(2.013), (I-655)+(1.011)+(2.014), (I-655)+(1.011)+(2.015), (I-655)+(1.011)+(2.016), (I-655)+(1.011)+(2.017), (I-655)+(1.011)+(2.018), (I-655)+(1.011)+(2.019), (I-655)+(1.011)+(2.021), (I-655)+(1.011)+(2.028), (I-655)+(1.011)+(2.030), (I-655)+(1.011)+(2.038), (I-655)+(1.011)+(3.003), (I-655)+(1.011)+(3.007), (I-655)+(1.011)+(3.012), (I-655)+(1.011)+(3.013), (I-655)+(1.011)+(3.016), (I-655)+(1.011)+(3.017), (I-655)+(1.011)+(3.020), (I-655)+(1.011)+(3.025), (I-655)+(1.011)+(3.026), (I-655)+(1.011)+(3.030), (I-655)+(1.011)+(3.031), (I-655)+(1.011)+(5.003), (I-655)+(1.011)+(5.004), (I-655)+(1.011)+(5.005), (I-655)+(1.011)+(5.008), (I-655)+(1.011)+(5.009), (I-655)+(1.011)+(5.011), (I-655)+(1.011)+(5.012), (I-655)+(1.011)+(5.013), (I-655)+(1.011)+(5.015), (I-655)+(1.011)+(5.018), (I-655)+(1.011)+(5.019), (I-655)+(1.011)+(6.002), (I-655)+(1.011)+(7.001), (I-655)+(1.011)+(7.005), (I-655)+(1.011)+(9.002), (I-655)+(1.011)+(9.004), (I-655)+(1.011)+(14.001), (I-655)+(1.011)+(14.002), (I-655)+(1.011)+(15.008), (I-655)+(1.011)+(15.011), (I-655)+(1.011)+(15.012), (I-655)+(1.011)+(15.016), (I-655)+(1.011)+(15.025), (I-655)+(1.011)+(15.027), (I-655)+(1.011)+(15.047), (I-655)+(1.011)+(15.063), (I-655)+(1.011)+(15.064), (I-655)+(1.011)+(16.001), (I-655)+(1.011)+(16.005), (I-655)+(1.011)+(17.001), (I-655)+(1.011)+(17.002), (I-655)+(1.011)+(17.003), (I-655)+(1.011)+(17.008), (I-655)+(1.011)+(18.001),

(I-655)+(1.012)+(1.001), (I-655)+(1.012)+(1.002), (I-655)+(1.012)+(1.003), (I-655)+(1.012)+(1.004), (I-655)+(1.012)+(1.005), (I-655)+(1.012)+(1.006), (I-655)+(1.012)+(1.007), (I-655)+(1.012)+(1.010), (I-655)+(1.012)+(1.011), (I-655)+(1.012)+(1.013), (I-655)+(1.012)+(1.017), (I-655)+(1.012)+(1.018), (I-655)+(1.012)+(1.020), (I-655)+(1.012)+(1.021), (I-655)+(1.012)+(1.026), (I-655)+(1.012)+(1.027), (I-655)+(1.012)+(1.055), (I-655)+(1.012)+(1.059), (I-655)+(1.012)+(1.092), (I-655)+(1.012)+(2.001), (I-655)+(1.012)+(2.002), (I-655)+(1.012)+(2.003), (I-655)+(1.012)+(2.005), (I-655)+(1.012)+(2.007), (I-655)+(1.012)+(2.009), (I-655)+(1.012)+(2.010), (I-655)+(1.012)+(2.011), (I-655)+(1.012)+(2.012), (I-655)+(1.012)+(2.013), (I-655)+(1.012)+(2.014), (I-655)+(1.012)+(2.015), (I-655)+(1.012)+(2.016), (I-655)+(1.012)+(2.017), (I-655)+(1.012)+(2.018), (I-655)+(1.012)+(2.019), (I-655)+(1.012)+(2.021), (I-655)+(1.012)+(2.028), (I-655)+(1.012)+(2.030), (I-655)+(1.012)+(2.038), (I-655)+(1.012)+(3.003), (I-655)+(1.012)+(3.007), (I-655)+(1.012)+(3.012), (I-655)+(1.012)+(3.013), (I-655)+(1.012)+(3.016), (I-655)+(1.012)+(3.017), (I-655)+(1.012)+(3.020), (I-655)+(1.012)+(3.025), (I-655)+(1.012)+(3.026), (I-655)+(1.012)+(3.030), (I-655)+(1.012)+(3.031), (I-655)+(1.012)+(5.003), (I-655)+(1.012)+(5.004), (I-655)+(1.012)+(5.005), (I-655)+(1.012)+(5.008), (I-655)+(1.012)+(5.009), (I-655)+(1.012)+(5.011), (I-655)+(1.012)+(5.012), (I-655)+(1.012)+(5.013), (I-655)+(1.012)+(5.015), (I-655)+(1.012)+(5.018), (I-655)+(1.012)+(5.019), (I-655)+(1.012)+(6.002), (I-655)+(1.012)+(7.001), (I-655)+(1.012)+(7.005), (I-655)+(1.012)+(9.002), (I-655)+(1.012)+(9.004), (I-655)+(1.012)+(14.001), (I-655)+(1.012)+(14.002), (I-655)+(1.012)+(15.008), (I-655)+(1.012)+(15.011), (I-655)+(1.012)+(15.012), (I-655)+(1.012)+(15.016), (I-655)+(1.012)+(15.025), (I-655)+(1.012)+(15.027), (I-655)+(1.012)+(15.047), (I-655)+(1.012)+(15.063), (I-655)+(1.012)+(15.064), (I-655)+(1.012)+(16.001), (I-655)+(1.012)+(16.005), (I-655)+(1.012)+(17.001), (I-655)+(1.012)+(17.002), (I-655)+(1.012)+(17.003), (I-655)+(1.012)+(17.008), (I-655)+(1.012)+(18.001),

(I-655)+(1.013)+(1.001), (I-655)+(1.013)+(1.002), (I-655)+(1.013)+(1.003), (I-655)+(1.013)+(1.004), (I-655)+(1.013)+(1.005), (I-655)+(1.013)+(1.006), (I-655)+(1.013)+(1.007), (I-655)+(1.013)+(1.010), (I-655)+(1.013)+(1.011), (I-655)+(1.013)+(1.012), (I-655)+(1.013)+(1.017), (I-655)+(1.013)+(1.018), (I-655)+(1.013)+(1.020), (I-655)+(1.013)+(1.021), (I-655)+(1.013)+(1.026), (I-655)+(1.013)+(1.027), (I-655)+(1.013)+(1.055), (I-655)+(1.013)+(1.059), (I-655)+(1.013)+(1.092), (I-655)+(1.013)+(2.001), (I-655)+(1.013)+(2.002), (I-655)+(1.013)+(2.003), (I-655)+(1.013)+(2.005), (I-655)+(1.013)+(2.007), (I-655)+(1.013)+(2.009), (I-655)+(1.013)+(2.010), (I-655)+(1.013)+(2.011), (I-655)+(1.013)+(2.012), (I-655)+(1.013)+(2.013), (I-655)+(1.013)+(2.014), (I-655)+(1.013)+(2.015), (I-655)+(1.013)+(2.016), (I-655)+(1.013)+(2.017), (I-655)+(1.013)+(2.018), (I-655)+(1.013)+(2.019), (I-655)+(1.013)+(2.021), (I-655)+(1.013)+(2.028), (I-655)+(1.013)+(2.030), (I-655)+(1.013)+(2.038), (I-655)+(1.013)+(3.003), (I-655)+(1.013)+(3.007), (I-655)+(1.013)+(3.012), (I-655)+(1.013)+(3.013), (I-655)+(1.013)+(3.016), (I-655)+(1.013)+(3.017), (I-655)+(1.013)+(3.020), (I-655)+(1.013)+(3.025), (I-655)+(1.013)+(3.026), (I-655)+(1.013)+(3.030), (I-655)+(1.013)+(3.031), (I-655)+(1.013)+(5.003), (I-655)+(1.013)+(5.004), (I-655)+(1.013)+(5.005), (I-655)+(1.013)+(5.008), (I-655)+(1.013)+(5.009), (I-655)+(1.013)+(5.011), (I-655)+(1.013)+(5.012), (I-655)+(1.013)+(5.013), (I-655)+(1.013)+(5.015), (I-655)+(1.013)+(5.018), (I-655)+(1.013)+(5.019), (I-655)+(1.013)+(6.002), (I-655)+(1.013)+(7.001), (I-655)+(1.013)+(7.005), (I-655)+(1.013)+(9.002), (I-655)+(1.013)+(9.004), (I-655)+(1.013)+(14.001), (I-655)+(1.013)+(14.002), (I-655)+(1.013)+(15.008), (I-655)+(1.013)+(15.011), (I-655)+(1.013)+(15.012), (I-655)+(1.013)+(15.016), (I-655)+(1.013)+(15.025), (I-655)+(1.013)+(15.027), (I-655)+(1.013)+(15.047), (I-655)+(1.013)+(15.063), (I-655)+(1.013)+(15.064), (I-655)+(1.013)+(16.001), (I-655)+(1.013)+(16.005), (I-655)+(1.013)+(17.001), (I-655)+(1.013)+(17.002), (I-655)+(1.013)+(17.003), (I-655)+(1.013)+(17.008), (I-655)+(1.013)+(18.001),

(I-655)+(1.017)+(1.001), (I-655)+(1.017)+(1.002), (I-655)+(1.017)+(1.003), (I-655)+(1.017)+(1.004), (I-655)+(1.017)+(1.005), (I-655)+(1.017)+(1.006), (I-655)+(1.017)+(1.007), (I-655)+(1.017)+(1.010), (I-655)+(1.017)+(1.011), (I-655)+(1.017)+(1.012), (I-655)+(1.017)+(1.013), (I-655)+(1.017)+(1.018), (I-655)+(1.017)+(1.020), (I-655)+(1.017)+(1.021), (I-655)+(1.017)+(1.026), (I-655)+(1.017)+(1.027), (I-655)+(1.017)+(1.055), (I-655)+(1.017)+(1.059), (I-655)+(1.017)+(1.092), (I-655)+(1.017)+(2.001), (I-655)+(1.017)+(2.002), (I-655)+(1.017)+(2.003), (I-655)+(1.017)+(2.005), (I-655)+(1.017)+(2.007), (I-655)+(1.017)+(2.009), (I-655)+(1.017)+(2.010), (I-655)+(1.017)+(2.011), (I-655)+(1.017)+(2.012), (I-655)+(1.017)+(2.013), (I-655)+(1.017)+(2.014), (I-655)+(1.017)+(2.015), (I-655)+(1.017)+(2.016), (I-655)+(1.017)+(2.017), (I-655)+(1.017)+(2.018), (I-655)+(1.017)+(2.019), (I-655)+(1.017)+(2.021), (I-655)+(1.017)+(2.028), (I-655)+(1.017)+(2.030), (I-655)+(1.017)+(2.038), (I-655)+(1.017)+(3.003), (I-655)+(1.017)+(3.007), (I-655)+(1.017)+(3.012), (I-655)+(1.017)+(3.013), (I-655)+(1.017)+(3.016), (I-655)+(1.017)+(3.017), (I-655)+(1.017)+(3.020), (I-655)+(1.017)+(3.025), (I-655)+(1.017)+(3.026), (I-655)+(1.017)+(3.030), (I-655)+(1.017)+(3.031), (I-655)+(1.017)+(5.003), (I-655)+(1.017)+(5.004), (I-655)+(1.017)+(5.005), (I-655)+(1.017)+(5.008), (I-655)+(1.017)+(5.009), (I-655)+(1.017)+(5.011), (I-655)+(1.017)+(5.012), (I-655)+(1.017)+(5.013), (I-655)+(1.017)+(5.015), (I-655)+(1.017)+(5.018), (I-655)+(1.017)+(5.019), (I-655)+(1.017)+(6.002), (I-655)+(1.017)+(7.001), (I-655)+(1.017)+(7.005), (I-655)+(1.017)+(9.002), (I-655)+(1.017)+(9.004), (I-655)+(1.017)+(14.001), (I-655)+(1.017)+(14.002), (I-655)+(1.017)+(15.008), (I-655)+(1.017)+(15.011), (I-655)+(1.017)+(15.012), (I-655)+(1.017)+(15.016), (I-655)+(1.017)+(15.025), (I-655)+(1.017)+(15.027), (I-655)+(1.017)+(15.047), (I-655)+(1.017)+(15.063), (I-655)+(1.017)+(15.064), (I-655)+(1.017)+(16.001), (I-655)+(1.017)+(16.005), (I-655)+(1.017)+(17.001), (I-655)+(1.017)+(17.002), (I-655)+(1.017)+(17.003), (I-655)+(1.017)+(17.008), (I-655)+(1.017)+(18.001),

(I-655)+(1.018)+(1.001), (I-655)+(1.018)+(1.002), (I-655)+(1.018)+(1.003), (I-655)+(1.018)+(1.004), (I-655)+(1.018)+(1.005), (I-655)+(1.018)+(1.006), (I-655)+(1.018)+(1.007), (I-655)+(1.018)+(1.010), (I-655)+(1.018)+(1.011), (I-655)+(1.018)+(1.012), (I-655)+(1.018)+(1.013), (I-655)+(1.018)+(1.017), (I-655)+(1.018)+(1.020), (I-655)+(1.018)+(1.021), (I-655)+(1.018)+(1.026), (I-655)+(1.018)+(1.027), (I-655)+(1.018)+(1.055), (I-655)+(1.018)+(1.059), (I-655)+(1.018)+(1.092), (I-655)+(1.018)+(2.001), (I-655)+(1.018)+(2.002), (I-655)+(1.018)+(2.003), (I-655)+(1.018)+(2.005), (I-655)+(1.018)+(2.007), (I-655)+(1.018)+(2.009), (I-655)+(1.018)+(2.010), (I-655)+(1.018)+(2.011), (I-655)+(1.018)+(2.012), (I-655)+(1.018)+(2.013), (I-655)+(1.018)+(2.014), (I-655)+(1.018)+(2.015), (I-655)+(1.018)+(2.016), (I-655)+(1.018)+(2.017), (I-655)+(1.018)+(2.018), (I-655)+(1.018)+(2.019), (I-655)+(1.018)+(2.021), (I-655)+(1.018)+(2.028), (I-655)+(1.018)+(2.030), (I-655)+(1.018)+(2.038), (I-655)+(1.018)+(3.003), (I-655)+(1.018)+(3.007), (I-655)+(1.018)+(3.012), (I-655)+(1.018)+(3.013), (I-655)+(1.018)+(3.016), (I-655)+(1.018)+(3.017), (I-655)+(1.018)+(3.020), (I-655)+(1.018)+(3.025), (I-655)+(1.018)+(3.026), (I-655)+(1.018)+(3.030), (I-655)+(1.018)+(3.031), (I-655)+(1.018)+(5.003), (I-655)+(1.018)+(5.004), (I-655)+(1.018)+(5.005), (I-655)+(1.018)+(5.008), (I-655)+(1.018)+(5.009), (I-655)+(1.018)+(5.011), (I-655)+(1.018)+(5.012), (I-655)+(1.018)+(5.013), (I-655)+(1.018)+(5.015), (I-655)+(1.018)+(5.018), (I-655)+(1.018)+(5.019), (I-655)+(1.018)+(6.002), (I-655)+(1.018)+(7.001), (I-655)+(1.018)+(7.005), (I-655)+(1.018)+(9.002), (I-655)+(1.018)+(9.004), (I-655)+(1.018)+(14.001), (I-655)+(1.018)+(14.002), (I-655)+(1.018)+(15.008), (I-655)+(1.018)+(15.011), (I-655)+(1.018)+(15.012), (I-655)+(1.018)+(15.016), (I-655)+(1.018)+(15.025), (I-655)+(1.018)+(15.027), (I-655)+(1.018)+(15.047), (I-655)+(1.018)+(15.063), (I-655)+(1.018)+(15.064), (I-655)+(1.018)+(16.001), (I-655)+(1.018)+(16.005), (I-655)+(1.018)+(17.001), (I-655)+(1.018)+(17.002), (I-655)+(1.018)+(17.003), (I-655)+(1.018)+(17.008), (I-655)+(1.018)+(18.001),

(I-655)+(1.020)+(1.001), (I-655)+(1.020)+(1.002), (I-655)+(1.020)+(1.003), (I-655)+(1.020)+(1.004), (I-655)+(1.020)+(1.005), (I-655)+(1.020)+(1.006), (I-655)+(1.020)+(1.007), (I-655)+(1.020)+(1.010), (I-655)+(1.020)+(1.011), (I-655)+(1.020)+(1.012), (I-655)+(1.020)+(1.013), (I-655)+(1.020)+(1.017), (I-655)+(1.020)+(1.018), (I-655)+(1.020)+(1.021), (I-655)+(1.020)+(1.026), (I-655)+(1.020)+(1.027), (I-655)+(1.020)+(1.055), (I-655)+(1.020)+(1.059), (I-655)+(1.020)+(1.092), (I-655)+(1.020)+(2.001), (I-655)+(1.020)+(2.002), (I-655)+(1.020)+(2.003), (I-655)+(1.020)+(2.005), (I-655)+(1.020)+(2.007), (I-655)+(1.020)+(2.009), (I-655)+(1.020)+(2.010), (I-655)+(1.020)+(2.011), (I-655)+(1.020)+(2.012), (I-655)+(1.020)+(2.013), (I-655)+(1.020)+(2.014), (I-655)+(1.020)+(2.015), (I-655)+(1.020)+(2.016), (I-655)+(1.020)+(2.017), (I-655)+(1.020)+(2.018), (I-655)+(1.020)+(2.019), (I-655)+(1.020)+(2.021), (I-655)+(1.020)+(2.028), (I-655)+(1.020)+(2.030), (I-655)+(1.020)+(2.038), (I-655)+(1.020)+(3.003), (I-655)+(1.020)+(3.007), (I-655)+(1.020)+(3.012), (I-655)+(1.020)+(3.013), (I-655)+(1.020)+(3.016), (I-655)+(1.020)+(3.017), (I-655)+(1.020)+(3.020), (I-655)+(1.020)+(3.025), (I-655)+(1.020)+(3.026), (I-655)+(1.020)+(3.030), (I-655)+(1.020)+(3.031), (I-655)+(1.020)+(5.003), (I-655)+(1.020)+(5.004), (I-655)+(1.020)+(5.005), (I-655)+(1.020)+(5.008), (I-655)+(1.020)+(5.009), (I-655)+(1.020)+(5.011), (I-655)+(1.020)+(5.012), (I-655)+(1.020)+(5.013), (I-655)+(1.020)+(5.015), (I-655)+(1.020)+(5.018), (I-655)+(1.020)+(5.019), (I-655)+(1.020)+(6.002), (I-655)+(1.020)+(7.001), (I-655)+(1.020)+(7.005), (I-655)+(1.020)+(9.002), (I-655)+(1.020)+(9.004), (I-655)+(1.020)+(14.001), (I-655)+(1.020)+(14.002), (I-655)+(1.020)+(15.008), (I-655)+(1.020)+(15.011), (I-655)+(1.020)+(15.012), (I-655)+(1.020)+(15.016), (I-655)+(1.020)+(15.025), (I-655)+(1.020)+(15.027), (I-655)+(1.020)+(15.047), (I-655)+(1.020)+(15.063), (I-655)+(1.020)+(15.064), (I-655)+(1.020)+(16.001), (I-655)+(1.020)+(16.005), (I-655)+(1.020)+(17.001), (I-655)+(1.020)+(17.002), (I-655)+(1.020)+(17.003), (I-655)+(1.020)+(17.008), (I-655)+(1.020)+(18.001),

(I-655)+(1.021)+(1.001), (I-655)+(1.021)+(1.002), (I-655)+(1.021)+(1.003), (I-655)+(1.021)+(1.004), (I-655)+(1.021)+(1.005), (I-655)+(1.021)+(1.006), (I-655)+(1.021)+(1.007), (I-655)+(1.021)+(1.010), (I-655)+(1.021)+(1.011), (I-655)+(1.021)+(1.012), (I-655)+(1.021)+(1.013), (I-655)+(1.021)+(1.017), (I-655)+(1.021)+(1.018), (I-655)+(1.021)+(1.020), (I-655)+(1.021)+(1.026), (I-655)+(1.021)+(1.027), (I-655)+(1.021)+(1.055), (I-655)+(1.021)+(1.059), (I-655)+(1.021)+(1.092), (I-655)+(1.021)+(2.001), (I-655)+(1.021)+(2.002), (I-655)+(1.021)+(2.003), (I-655)+(1.021)+(2.005), (I-655)+(1.021)+(2.007), (I-655)+(1.021)+(2.009), (I-655)+(1.021)+(2.010), (I-655)+(1.021)+(2.011), (I-655)+(1.021)+(2.012), (I-655)+(1.021)+(2.013), (I-655)+(1.021)+(2.014), (I-655)+(1.021)+(2.015), (I-655)+(1.021)+(2.016), (I-655)+(1.021)+(2.017), (I-655)+(1.021)+(2.018), (I-655)+(1.021)+(2.019), (I-655)+(1.021)+(2.021), (I-655)+(1.021)+(2.028), (I-655)+(1.021)+(2.030), (I-655)+(1.021)+(2.038), (I-655)+(1.021)+(3.003), (I-655)+(1.021)+(3.007), (I-655)+(1.021)+(3.012), (I-655)+(1.021)+(3.013), (I-655)+(1.021)+(3.016), (I-655)+(1.021)+(3.017), (I-655)+(1.021)+(3.020), (I-655)+(1.021)+(3.025), (I-655)+(1.021)+(3.026), (I-655)+(1.021)+(3.030), (I-655)+(1.021)+(3.031), (I-655)+(1.021)+(5.003), (I-655)+(1.021)+(5.004), (I-655)+(1.021)+(5.005), (I-655)+(1.021)+(5.008), (I-655)+(1.021)+(5.009), (I-655)+(1.021)+(5.011), (I-655)+(1.021)+(5.012), (I-655)+(1.021)+(5.013), (I-655)+(1.021)+(5.015), (I-655)+(1.021)+(5.018), (I-655)+(1.021)+(5.019), (I-655)+(1.021)+(6.002), (I-655)+(1.021)+(7.001), (I-655)+(1.021)+(7.005), (I-655)+(1.021)+(9.002), (I-655)+(1.021)+(9.004), (I-655)+(1.021)+(14.001), (I-655)+(1.021)+(14.002), (I-655)+(1.021)+(15.008), (I-655)+(1.021)+(15.011), (I-655)+(1.021)+(15.012), (I-655)+(1.021)+(15.016), (I-655)+(1.021)+(15.025), (I-655)+(1.021)+(15.027), (I-655)+(1.021)+(15.047), (I-655)+(1.021)+(15.063), (I-655)+(1.021)+(15.064), (I-655)+(1.021)+(16.001), (I-655)+(1.021)+(16.005), (I-655)+(1.021)+(17.001), (I-655)+(1.021)+(17.002), (I-655)+(1.021)+(17.003), (I-655)+(1.021)+(17.008), (I-655)+(1.021)+(18.001),

(I-655)+(1.026)+(1.001), (I-655)+(1.026)+(1.002), (I-655)+(1.026)+(1.003), (I-655)+(1.026)+(1.004), (I-655)+(1.026)+(1.005), (I-655)+(1.026)+(1.006), (I-655)+(1.026)+(1.007), (I-655)+(1.026)+(1.010), (I-655)+(1.026)+(1.011), (I-655)+(1.026)+(1.012), (I-655)+(1.026)+(1.013), (I-655)+(1.026)+(1.017), (I-655)+(1.026)+(1.018), (I-655)+(1.026)+(1.020), (I-655)+(1.026)+(1.021), (I-655)+(1.026)+(1.027), (I-655)+(1.026)+(1.055), (I-655)+(1.026)+(1.059), (I-655)+(1.026)+(1.092), (I-655)+(1.026)+(2.001), (I-655)+(1.026)+(2.002), (I-655)+(1.026)+(2.003), (I-655)+(1.026)+(2.005), (I-655)+(1.026)+(2.007), (I-655)+(1.026)+(2.009), (I-655)+(1.026)+(2.010), (I-655)+(1.026)+(2.011), (I-655)+(1.026)+(2.012), (I-655)+(1.026)+(2.013), (I-655)+(1.026)+(2.014), (I-655)+(1.026)+(2.015), (I-655)+(1.026)+(2.016), (I-655)+(1.026)+(2.017), (I-655)+(1.026)+(2.018), (I-655)+(1.026)+(2.019), (I-655)+(1.026)+(2.021), (I-655)+(1.026)+(2.028), (I-655)+(1.026)+(2.030), (I-655)+(1.026)+(2.038), (I-655)+(1.026)+(3.003), (I-655)+(1.026)+(3.007), (I-655)+(1.026)+(3.012), (I-655)+(1.026)+(3.013), (I-655)+(1.026)+(3.016), (I-655)+(1.026)+(3.017), (I-655)+(1.026)+(3.020), (I-655)+(1.026)+(3.025), (I-655)+(1.026)+(3.026), (I-655)+(1.026)+(3.030), (I-655)+(1.026)+(3.031), (I-655)+(1.026)+(5.003), (I-655)+(1.026)+(5.004), (I-655)+(1.026)+(5.005), (I-655)+(1.026)+(5.008), (I-655)+(1.026)+(5.009), (I-655)+(1.026)+(5.011), (I-655)+(1.026)+(5.012), (I-655)+(1.026)+(5.013), (I-655)+(1.026)+(5.015), (I-655)+(1.026)+(5.018), (I-655)+(1.026)+(5.019), (I-655)+(1.026)+(6.002), (I-655)+(1.026)+(7.001), (I-655)+(1.026)+(7.005), (I-655)+(1.026)+(9.002), (I-655)+(1.026)+(9.004), (I-655)+(1.026)+(14.001), (I-655)+(1.026)+(14.002), (I-655)+(1.026)+(15.008), (I-655)+(1.026)+(15.011), (I-655)+(1.026)+(15.012), (I-655)+(1.026)+(15.016), (I-655)+(1.026)+(15.025), (I-655)+(1.026)+(15.027), (I-655)+(1.026)+(15.047), (I-655)+(1.026)+(15.063), (I-655)+(1.026)+(15.064), (I-655)+(1.026)+(16.001), (I-655)+(1.026)+(16.005), (I-655)+(1.026)+(17.001), (I-655)+(1.026)+(17.002), (I-655)+(1.026)+(17.003), (I-655)+(1.026)+(17.008), (I-655)+(1.026)+(18.001),

(I-655)+(1.027)+(1.001), (I-655)+(1.027)+(1.002), (I-655)+(1.027)+(1.003), (I-655)+(1.027)+(1.004), (I-655)+(1.027)+(1.005), (I-655)+(1.027)+(1.006), (I-655)+(1.027)+(1.007), (I-655)+(1.027)+(1.010), (I-655)+(1.027)+(1.011), (I-655)+(1.027)+(1.012), (I-655)+(1.027)+(1.013), (I-655)+(1.027)+(1.017), (I-655)+(1.027)+(1.018), (I-655)+(1.027)+(1.020), (I-655)+(1.027)+(1.021), (I-655)+(1.027)+(1.026), (I-655)+(1.027)+(1.055), (I-655)+(1.027)+(1.059), (I-655)+(1.027)+(1.092), (I-655)+(1.027)+(2.001), (I-655)+(1.027)+(2.002), (I-655)+(1.027)+(2.003), (I-655)+(1.027)+(2.005), (I-655)+(1.027)+(2.007), (I-655)+(1.027)+(2.009), (I-655)+(1.027)+(2.010), (I-655)+(1.027)+(2.011), (I-655)+(1.027)+(2.012), (I-655)+(1.027)+(2.013), (I-655)+(1.027)+(2.014), (I-655)+(1.027)+(2.015), (I-655)+(1.027)+(2.016), (I-655)+(1.027)+(2.017), (I-655)+(1.027)+(2.018), (I-655)+(1.027)+(2.019), (I-655)+(1.027)+(2.021), (I-655)+(1.027)+(2.028), (I-655)+(1.027)+(2.030), (I-655)+(1.027)+(2.038), (I-655)+(1.027)+(3.003), (I-655)+(1.027)+(3.007), (I-655)+(1.027)+(3.012), (I-655)+(1.027)+(3.013), (I-655)+(1.027)+(3.016), (I-655)+(1.027)+(3.017), (I-655)+(1.027)+(3.020), (I-655)+(1.027)+(3.025), (I-655)+(1.027)+(3.026), (I-655)+(1.027)+(3.030), (I-655)+(1.027)+(3.031), (I-655)+(1.027)+(5.003), (I-655)+(1.027)+(5.004), (I-655)+(1.027)+(5.005), (I-655)+(1.027)+(5.008), (I-655)+(1.027)+(5.009), (I-655)+(1.027)+(5.011), (I-655)+(1.027)+(5.012), (I-655)+(1.027)+(5.013), (I-655)+(1.027)+(5.015), (I-655)+(1.027)+(5.018), (I-655)+(1.027)+(5.019), (I-655)+(1.027)+(6.002), (I-655)+(1.027)+(7.001), (I-655)+(1.027)+(7.005), (I-655)+(1.027)+(9.002), (I-655)+(1.027)+(9.004), (I-655)+(1.027)+(14.001), (I-655)+(1.027)+(14.002), (I-655)+(1.027)+(15.008), (I-655)+(1.027)+(15.011), (I-655)+(1.027)+(15.012), (I-655)+(1.027)+(15.016), (I-655)+(1.027)+(15.025), (I-655)+(1.027)+(15.027), (I-655)+(1.027)+(15.047), (I-655)+(1.027)+(15.063), (I-655)+(1.027)+(15.064), (I-655)+(1.027)+(16.001), (I-655)+(1.027)+(16.005), (I-655)+(1.027)+(17.001), (I-655)+(1.027)+(17.002), (I-655)+(1.027)+(17.003), (I-655)+(1.027)+(17.008), (I-655)+(1.027)+(18.001),

(I-655)+(1.055)+(1.001), (I-655)+(1.055)+(1.002), (I-655)+(1.055)+(1.003), (I-655)+(1.055)+(1.004), (I-655)+(1.055)+(1.005), (I-655)+(1.055)+(1.006), (I-655)+(1.055)+(1.007), (I-655)+(1.055)+(1.010), (I-655)+(1.055)+(1.011), (I-655)+(1.055)+(1.012), (I-655)+(1.055)+(1.013), (I-655)+(1.055)+(1.017), (I-655)+(1.055)+(1.018), (I-655)+(1.055)+(1.020), (I-655)+(1.055)+(1.021), (I-655)+(1.055)+(1.026), (I-655)+(1.055)+(1.027), (I-655)+(1.055)+(1.059), (I-655)+(1.055)+(1.092), (I-655)+(1.055)+(2.001), (I-655)+(1.055)+(2.002), (I-655)+(1.055)+(2.003), (I-655)+(1.055)+(2.005), (I-655)+(1.055)+(2.007), (I-655)+(1.055)+(2.009), (I-655)+(1.055)+(2.010), (I-655)+(1.055)+(2.011), (I-655)+(1.055)+(2.012), (I-655)+(1.055)+(2.013), (I-655)+(1.055)+(2.014), (I-655)+(1.055)+(2.015), (I-655)+(1.055)+(2.016), (I-655)+(1.055)+(2.017), (I-655)+(1.055)+(2.018), (I-655)+(1.055)+(2.019), (I-655)+(1.055)+(2.021), (I-655)+(1.055)+(2.028), (I-655)+(1.055)+(2.030), (I-655)+(1.055)+(2.038), (I-655)+(1.055)+(3.003), (I-655)+(1.055)+(3.007), (I-655)+(1.055)+(3.012), (I-655)+(1.055)+(3.013), (I-655)+(1.055)+(3.016), (I-655)+(1.055)+(3.017), (I-655)+(1.055)+(3.020), (I-655)+(1.055)+(3.025), (I-655)+(1.055)+(3.026), (I-655)+(1.055)+(3.030), (I-655)+(1.055)+(3.031), (I-655)+(1.055)+(5.003), (I-655)+(1.055)+(5.004), (I-655)+(1.055)+(5.005), (I-655)+(1.055)+(5.008), (I-655)+(1.055)+(5.009), (I-655)+(1.055)+(5.011), (I-655)+(1.055)+(5.012), (I-655)+(1.055)+(5.013), (I-655)+(1.055)+(5.015), (I-655)+(1.055)+(5.018), (I-655)+(1.055)+(5.019), (I-655)+(1.055)+(6.002), (I-655)+(1.055)+(7.001), (I-655)+(1.055)+(7.005), (I-655)+(1.055)+(9.002), (I-655)+(1.055)+(9.004), (I-655)+(1.055)+(14.001), (I-655)+(1.055)+(14.002), (I-655)+(1.055)+(15.008), (I-655)+(1.055)+(15.011), (I-655)+(1.055)+(15.012), (I-655)+(1.055)+(15.016), (I-655)+(1.055)+(15.025), (I-655)+(1.055)+(15.027), (I-655)+(1.055)+(15.047), (I-655)+(1.055)+(15.063), (I-655)+(1.055)+(15.064), (I-655)+(1.055)+(16.001), (I-655)+(1.055)+(16.005), (I-655)+(1.055)+(17.001), (I-655)+(1.055)+(17.002), (I-655)+(1.055)+(17.003), (I-655)+(1.055)+(17.008), (I-655)+(1.055)+(18.001),

(I-655)+(1.059)+(1.001), (I-655)+(1.059)+(1.002), (I-655)+(1.059)+(1.003), (I-655)+(1.059)+(1.004), (I-655)+(1.059)+(1.005), (I-655)+(1.059)+(1.006), (I-655)+(1.059)+(1.007), (I-655)+(1.059)+(1.010), (I-655)+(1.059)+(1.011), (I-655)+(1.059)+(1.012), (I-655)+(1.059)+(1.013), (I-655)+(1.059)+(1.017), (I-655)+(1.059)+(1.018), (I-655)+(1.059)+(1.020), (I-655)+(1.059)+(1.021), (I-655)+(1.059)+(1.026), (I-655)+(1.059)+(1.027), (I-655)+(1.059)+(1.055), (I-655)+(1.059)+(1.092), (I-655)+(1.059)+(2.001), (I-655)+(1.059)+(2.002), (I-655)+(1.059)+(2.003), (I-655)+(1.059)+(2.005), (I-655)+(1.059)+(2.007), (I-655)+(1.059)+(2.009), (I-655)+(1.059)+(2.010), (I-655)+(1.059)+(2.011), (I-655)+(1.059)+(2.012), (I-655)+(1.059)+(2.013), (I-655)+(1.059)+(2.014), (I-655)+(1.059)+(2.015), (I-655)+(1.059)+(2.016), (I-655)+(1.059)+(2.017), (I-655)+(1.059)+(2.018), (I-655)+(1.059)+(2.019), (I-655)+(1.059)+(2.021), (I-655)+(1.059)+(2.028), (I-655)+(1.059)+(2.030), (I-655)+(1.059)+(2.038), (I-655)+(1.059)+(3.003), (I-655)+(1.059)+(3.007), (I-655)+(1.059)+(3.012), (I-655)+(1.059)+(3.013), (I-655)+(1.059)+(3.016), (I-655)+(1.059)+(3.017), (I-655)+(1.059)+(3.020), (I-655)+(1.059)+(3.025), (I-655)+(1.059)+(3.026), (I-655)+(1.059)+(3.030), (I-655)+(1.059)+(3.031), (I-655)+(1.059)+(5.003), (I-655)+(1.059)+(5.004), (I-655)+(1.059)+(5.005), (I-655)+(1.059)+(5.008), (I-655)+(1.059)+(5.009), (I-655)+(1.059)+(5.011), (I-655)+(1.059)+(5.012), (I-655)+(1.059)+(5.013), (I-655)+(1.059)+(5.015), (I-655)+(1.059)+(5.018), (I-655)+(1.059)+(5.019), (I-655)+(1.059)+(6.002), (I-655)+(1.059)+(7.001), (I-655)+(1.059)+(7.005), (I-655)+(1.059)+(9.002), (I-655)+(1.059)+(9.004), (I-655)+(1.059)+(14.001), (I-655)+(1.059)+(14.002), (I-655)+(1.059)+(15.008), (I-655)+(1.059)+(15.011), (I-655)+(1.059)+(15.012), (I-655)+(1.059)+(15.016), (I-655)+(1.059)+(15.025), (I-655)+(1.059)+(15.027), (I-655)+(1.059)+(15.047), (I-655)+(1.059)+(15.063), (I-655)+(1.059)+(15.064), (I-655)+(1.059)+(16.001), (I-655)+(1.059)+(16.005), (I-655)+(1.059)+(17.001), (I-655)+(1.059)+(17.002), (I-655)+(1.059)+(17.003), (I-655)+(1.059)+(17.008), (I-655)+(1.059)+(18.001),

(I-655)+(1.092)+(1.001), (I-655)+(1.092)+(1.002), (I-655)+(1.092)+(1.003), (I-655)+(1.092)+(1.004), (I-655)+(1.092)+(1.005), (I-655)+(1.092)+(1.006), (I-655)+(1.092)+(1.007), (I-655)+(1.092)+(1.010), (I-655)+(1.092)+(1.011), (I-655)+(1.092)+(1.012), (I-655)+(1.092)+(1.013), (I-655)+(1.092)+(1.017), (I-655)+(1.092)+(1.018), (I-655)+(1.092)+(1.020), (I-655)+(1.092)+(1.021), (I-655)+(1.092)+(1.026), (I-655)+(1.092)+(1.027), (I-655)+(1.092)+(1.055), (I-655)+(1.092)+(1.059), (I-655)+(1.092)+(2.001), (I-655)+(1.092)+(2.002), (I-655)+(1.092)+(2.003), (I-655)+(1.092)+(2.005), (I-655)+(1.092)+(2.007), (I-655)+(1.092)+(2.009), (I-655)+(1.092)+(2.010), (I-655)+(1.092)+(2.011), (I-655)+(1.092)+(2.012), (I-655)+(1.092)+(2.013), (I-655)+(1.092)+(2.014), (I-655)+(1.092)+(2.015), (I-655)+(1.092)+(2.016), (I-655)+(1.092)+(2.017), (I-655)+(1.092)+(2.018), (I-655)+(1.092)+(2.019), (I-655)+(1.092)+(2.021), (I-655)+(1.092)+(2.028), (I-655)+(1.092)+(2.030), (I-655)+(1.092)+(2.038), (I-655)+(1.092)+(3.003), (I-655)+(1.092)+(3.007), (I-655)+(1.092)+(3.012), (I-655)+(1.092)+(3.013), (I-655)+(1.092)+(3.016), (I-655)+(1.092)+(3.017), (I-655)+(1.092)+(3.020), (I-655)+(1.092)+(3.025), (I-655)+(1.092)+(3.026), (I-655)+(1.092)+(3.030), (I-655)+(1.092)+(3.031), (I-655)+(1.092)+(5.003), (I-655)+(1.092)+(5.004), (I-655)+(1.092)+(5.005), (I-655)+(1.092)+(5.008), (I-655)+(1.092)+(5.009), (I-655)+(1.092)+(5.011), (I-655)+(1.092)+(5.012), (I-655)+(1.092)+(5.013), (I-655)+(1.092)+(5.015), (I-655)+(1.092)+(5.018), (I-655)+(1.092)+(5.019), (I-655)+(1.092)+(6.002), (I-655)+(1.092)+(7.001), (I-655)+(1.092)+(7.005), (I-655)+(1.092)+(9.002), (I-655)+(1.092)+(9.004), (I-655)+(1.092)+(14.001), (I-655)+(1.092)+(14.002), (I-655)+(1.092)+(15.008), (I-655)+(1.092)+(15.011), (I-655)+(1.092)+(15.012), (I-655)+(1.092)+(15.016), (I-655)+(1.092)+(15.025), (I-655)+(1.092)+(15.027), (I-655)+(1.092)+(15.047), (I-655)+(1.092)+(15.063), (I-655)+(1.092)+(15.064), (I-655)+(1.092)+(16.001), (I-655)+(1.092)+(16.005), (I-655)+(1.092)+(17.001), (I-655)+(1.092)+(17.002), (I-655)+(1.092)+(17.003), (I-655)+(1.092)+(17.008), (I-655)+(1.092)+(18.001),

(I-655)+(2.001)+(3.003), (I-655)+(2.001)+(3.007), (I-655)+(2.001)+(3.012), (I-655)+(2.001)+(3.013), (I-655)+(2.001)+(3.016), (I-655)+(2.001)+(3.017), (I-655)+(2.001)+(3.020), (I-655)+(2.001)+(3.025), (I-655)+(2.001)+(3.026), (I-655)+(2.001)+(3.030), (I-655)+(2.001)+(3.031), (I-655)+(2.001)+(5.003), (I-655)+(2.001)+(5.004), (I-655)+(2.001)+(5.005), (I-655)+(2.001)+(5.008), (I-655)+(2.001)+(5.009), (I-655)+(2.001)+(5.011), (I-655)+(2.001)+(5.012), (I-655)+(2.001)+(5.013), (I-655)+(2.001)+(5.015), (I-655)+(2.001)+(5.018), (I-655)+(2.001)+(5.019), (I-655)+(2.001)+(6.002), (I-655)+(2.001)+(7.001), (I-655)+(2.001)+(7.005), (I-655)+(2.001)+(9.002), (I-655)+(2.001)+(9.004), (I-655)+(2.001)+(14.001), (I-655)+(2.001)+(14.002), (I-655)+(2.001)+(15.008), (I-655)+(2.001)+(15.011), (I-655)+(2.001)+(15.012), (I-655)+(2.001)+(15.016), (I-655)+(2.001)+(15.025), (I-655)+(2.001)+(15.027), (I-655)+(2.001)+(15.047), (I-655)+(2.001)+(15.063), (I-655)+(2.001)+(15.064), (I-655)+(2.001)+(16.001), (I-655)+(2.001)+(16.005), (I-655)+(2.001)+(17.001), (I-655)+(2.001)+(17.002), (I-655)+(2.001)+(17.003), (I-655)+(2.001)+(17.008), (I-655)+(2.001)+(18.001),

(I-655)+(2.002)+(3.003), (I-655)+(2.002)+(3.007), (I-655)+(2.002)+(3.012), (I-655)+(2.002)+(3.013), (I-655)+(2.002)+(3.016), (I-655)+(2.002)+(3.017), (I-655)+(2.002)+(3.020), (I-655)+(2.002)+(3.025), (I-655)+(2.002)+(3.026), (I-655)+(2.002)+(3.030), (I-655)+(2.002)+(3.031), (I-655)+(2.002)+(5.003), (I-655)+(2.002)+(5.004), (I-655)+(2.002)+(5.005), (I-655)+(2.002)+(5.008), (I-655)+(2.002)+(5.009), (I-655)+(2.002)+(5.011), (I-655)+(2.002)+(5.012), (I-655)+(2.002)+(5.013), (I-655)+(2.002)+(5.015), (I-655)+(2.002)+(5.018), (I-655)+(2.002)+(5.019), (I-655)+(2.002)+(6.002), (I-655)+(2.002)+(7.001), (I-655)+(2.002)+(7.005), (I-655)+(2.002)+(9.002), (I-655)+(2.002)+(9.004), (I-655)+(2.002)+(14.001), (I-655)+(2.002)+(14.002), (I-655)+(2.002)+(15.008), (I-655)+(2.002)+(15.011), (I-655)+(2.002)+(15.012), (I-655)+(2.002)+(15.016), (I-655)+(2.002)+(15.025), (I-655)+(2.002)+(15.027), (I-655)+(2.002)+(15.047), (I-655)+(2.002)+(15.063), (I-655)+(2.002)+(15.064), (I-655)+(2.002)+(16.001), (I-655)+(2.002)+(16.005), (I-655)+(2.002)+(17.001), (I-655)+(2.002)+(17.002), (I-655)+(2.002)+(17.003), (I-655)+(2.002)+(17.008), (I-655)+(2.002)+(18.001),

(I-655)+(2.003)+(3.003), (I-655)+(2.003)+(3.007), (I-655)+(2.003)+(3.012), (I-655)+(2.003)+(3.013), (I-655)+(2.003)+(3.016), (I-655)+(2.003)+(3.017), (I-655)+(2.003)+(3.020), (I-655)+(2.003)+(3.025), (I-655)+(2.003)+(3.026), (I-655)+(2.003)+(3.030), (I-655)+(2.003)+(3.031), (I-655)+(2.003)+(5.003), (I-655)+(2.003)+(5.004), (I-655)+(2.003)+(5.005), (I-655)+(2.003)+(5.008), (I-655)+(2.003)+(5.009), (I-655)+(2.003)+(5.011), (I-655)+(2.003)+(5.012), (I-655)+(2.003)+(5.013), (I-655)+(2.003)+(5.015), (I-655)+(2.003)+(5.018), (I-655)+(2.003)+(5.019), (I-655)+(2.003)+(6.002), (I-655)+(2.003)+(7.001), (I-655)+(2.003)+(7.005), (I-655)+(2.003)+(9.002), (I-655)+(2.003)+(9.004), (I-655)+(2.003)+(14.001), (I-655)+(2.003)+(14.002), (I-655)+(2.003)+(15.008), (I-655)+(2.003)+(15.011), (I-655)+(2.003)+(15.012), (I-655)+(2.003)+(15.016), (I-655)+(2.003)+(15.025), (I-655)+(2.003)+(15.027), (I-655)+(2.003)+(15.047), (I-655)+(2.003)+(15.063), (I-655)+(2.003)+(15.064), (I-655)+(2.003)+(16.001), (I-655)+(2.003)+(16.005), (I-655)+(2.003)+(17.001), (I-655)+(2.003)+(17.002), (I-655)+(2.003)+(17.003), (I-655)+(2.003)+(17.008), (I-655)+(2.003)+(18.001),

(I-655)+(2.005)+(3.003), (I-655)+(2.005)+(3.007), (I-655)+(2.005)+(3.012), (I-655)+(2.005)+(3.013), (I-655)+(2.005)+(3.016), (I-655)+(2.005)+(3.017), (I-655)+(2.005)+(3.020), (I-655)+(2.005)+(3.025), (I-655)+(2.005)+(3.026), (I-655)+(2.005)+(3.030), (I-655)+(2.005)+(3.031), (I-655)+(2.005)+(5.003), (I-655)+(2.005)+(5.004), (I-655)+(2.005)+(5.005), (I-655)+(2.005)+(5.008), (I-655)+(2.005)+(5.009), (I-655)+(2.005)+(5.011), (I-655)+(2.005)+(5.012), (I-655)+(2.005)+(5.013), (I-655)+(2.005)+(5.015), (I-655)+(2.005)+(5.018), (I-655)+(2.005)+(5.019), (I-655)+(2.005)+(6.002), (I-655)+(2.005)+(7.001), (I-655)+(2.005)+(7.005), (I-655)+(2.005)+(9.002), (I-655)+(2.005)+(9.004), (I-655)+(2.005)+(14.001), (I-655)+(2.005)+(14.002), (I-655)+(2.005)+(15.008), (I-655)+(2.005)+(15.011), (I-655)+(2.005)+(15.012), (I-655)+(2.005)+(15.016), (I-655)+(2.005)+(15.025), (I-655)+(2.005)+(15.027), (I-655)+(2.005)+(15.047), (I-655)+(2.005)+(15.063), (I-655)+(2.005)+(15.064), (I-655)+(2.005)+(16.001), (I-655)+(2.005)+(16.005), (I-655)+(2.005)+(17.001), (I-655)+(2.005)+(17.002), (I-655)+(2.005)+(17.003), (I-655)+(2.005)+(17.008), (I-655)+(2.005)+(18.001),

(I-655)+(2.007)+(3.003), (I-655)+(2.007)+(3.007), (I-655)+(2.007)+(3.012), (I-655)+(2.007)+(3.013), (I-655)+(2.007)+(3.016), (I-655)+(2.007)+(3.017), (I-655)+(2.007)+(3.020), (I-655)+(2.007)+(3.025), (I-655)+(2.007)+(3.026), (I-655)+(2.007)+(3.030), (I-655)+(2.007)+(3.031), (I-655)+(2.007)+(5.003), (I-655)+(2.007)+(5.004), (I-655)+(2.007)+(5.005), (I-655)+(2.007)+(5.008), (I-655)+(2.007)+(5.009), (I-655)+(2.007)+(5.011), (I-655)+(2.007)+(5.012), (I-655)+(2.007)+(5.013), (I-655)+(2.007)+(5.015), (I-655)+(2.007)+(5.018), (I-655)+(2.007)+(5.019), (I-655)+(2.007)+(6.002), (I-655)+(2.007)+(7.001), (I-655)+(2.007)+(7.005), (I-655)+(2.007)+(9.002), (I-655)+(2.007)+(9.004), (I-655)+(2.007)+(14.001), (I-655)+(2.007)+(14.002), (I-655)+(2.007)+(15.008), (I-655)+(2.007)+(15.011), (I-655)+(2.007)+(15.012), (I-655)+(2.007)+(15.016), (I-655)+(2.007)+(15.025), (I-655)+(2.007)+(15.027), (I-655)+(2.007)+(15.047), (I-655)+(2.007)+(15.063), (I-655)+(2.007)+(15.064), (I-655)+(2.007)+(16.001), (I-655)+(2.007)+(16.005), (I-655)+(2.007)+(17.001), (I-655)+(2.007)+(17.002), (I-655)+(2.007)+(17.003), (I-655)+(2.007)+(17.008), (I-655)+(2.007)+(18.001),

(I-655)+(2.009)+(3.003), (I-655)+(2.009)+(3.007), (I-655)+(2.009)+(3.012), (I-655)+(2.009)+(3.013), (I-655)+(2.009)+(3.016), (I-655)+(2.009)+(3.017), (I-655)+(2.009)+(3.020), (I-655)+(2.009)+(3.025), (I-655)+(2.009)+(3.026), (I-655)+(2.009)+(3.030), (I-655)+(2.009)+(3.031), (I-655)+(2.009)+(5.003), (I-655)+(2.009)+(5.004), (I-655)+(2.009)+(5.005), (I-655)+(2.009)+(5.008), (I-655)+(2.009)+(5.009), (I-655)+(2.009)+(5.011), (I-655)+(2.009)+(5.012), (I-655)+(2.009)+(5.013), (I-655)+(2.009)+(5.015), (I-655)+(2.009)+(5.018), (I-655)+(2.009)+(5.019), (I-655)+(2.009)+(6.002), (I-655)+(2.009)+(7.001), (I-655)+(2.009)+(7.005), (I-655)+(2.009)+(9.002), (I-655)+(2.009)+(9.004), (I-655)+(2.009)+(14.001), (I-655)+(2.009)+(14.002), (I-655)+(2.009)+(15.008), (I-655)+(2.009)+(15.011), (I-655)+(2.009)+(15.012), (I-655)+(2.009)+(15.016), (I-655)+(2.009)+(15.025), (I-655)+(2.009)+(15.027), (I-655)+(2.009)+(15.047), (I-655)+(2.009)+(15.063), (I-655)+(2.009)+(15.064), (I-655)+(2.009)+(16.001), (I-655)+(2.009)+(16.005), (I-655)+(2.009)+(17.001), (I-655)+(2.009)+(17.002), (I-655)+(2.009)+(17.003), (I-655)+(2.009)+(17.008), (I-655)+(2.009)+(18.001),

(I-655)+(2.010)+(3.003), (I-655)+(2.010)+(3.007), (I-655)+(2.010)+(3.012), (I-655)+(2.010)+(3.013), (I-655)+(2.010)+(3.016), (I-655)+(2.010)+(3.017), (I-655)+(2.010)+(3.020), (I-655)+(2.010)+(3.025), (I-655)+(2.010)+(3.026), (I-655)+(2.010)+(3.030), (I-655)+(2.010)+(3.031), (I-655)+(2.010)+(5.003), (I-655)+(2.010)+(5.004), (I-655)+(2.010)+(5.005), (I-655)+(2.010)+(5.008), (I-655)+(2.010)+(5.009), (I-655)+(2.010)+(5.011), (I-655)+(2.010)+(5.012), (I-655)+(2.010)+(5.013), (I-655)+(2.010)+(5.015), (I-655)+(2.010)+(5.018), (I-655)+(2.010)+(5.019), (I-655)+(2.010)+(6.002), (I-655)+(2.010)+(7.001), (I-655)+(2.010)+(7.005), (I-655)+(2.010)+(9.002), (I-655)+(2.010)+(9.004), (I-655)+(2.010)+(14.001), (I-655)+(2.010)+(14.002), (I-655)+(2.010)+(15.008), (I-655)+(2.010)+(15.011), (I-655)+(2.010)+(15.012), (I-655)+(2.010)+(15.016), (I-655)+(2.010)+(15.025), (I-655)+(2.010)+(15.027), (I-655)+(2.010)+(15.047), (I-655)+(2.010)+(15.063), (I-655)+(2.010)+(15.064), (I-655)+(2.010)+(16.001), (I-655)+(2.010)+(16.005), (I-655)+(2.010)+(17.001), (I-655)+(2.010)+(17.002), (I-655)+(2.010)+(17.003), (I-655)+(2.010)+(17.008), (I-655)+(2.010)+(18.001),

(I-655)+(2.011)+(3.003), (I-655)+(2.011)+(3.007), (I-655)+(2.011)+(3.012), (I-655)+(2.011)+(3.013), (I-655)+(2.011)+(3.016), (I-655)+(2.011)+(3.017), (I-655)+(2.011)+(3.020), (I-655)+(2.011)+(3.025), (I-655)+(2.011)+(3.026), (I-655)+(2.011)+(3.030), (I-655)+(2.011)+(3.031), (I-655)+(2.011)+(5.003), (I-655)+(2.011)+(5.004), (I-655)+(2.011)+(5.005), (I-655)+(2.011)+(5.008), (I-655)+(2.011)+(5.009), (I-655)+(2.011)+(5.011), (I-655)+(2.011)+(5.012), (I-655)+(2.011)+(5.013), (I-655)+(2.011)+(5.015), (I-655)+(2.011)+(5.018), (I-655)+(2.011)+(5.019), (I-655)+(2.011)+(6.002), (I-655)+(2.011)+(7.001), (I-655)+(2.011)+(7.005), (I-655)+(2.011)+(9.002), (I-655)+(2.011)+(9.004), (I-655)+(2.011)+(14.001), (I-655)+(2.011)+(14.002), (I-655)+(2.011)+(15.008), (I-655)+(2.011)+(15.011), (I-655)+(2.011)+(15.012), (I-655)+(2.011)+(15.016), (I-655)+(2.011)+(15.025), (I-655)+(2.011)+(15.027), (I-655)+(2.011)+(15.047), (I-655)+(2.011)+(15.063), (I-655)+(2.011)+(15.064), (I-655)+(2.011)+(16.001), (I-655)+(2.011)+(16.005), (I-655)+(2.011)+(17.001), (I-655)+(2.011)+(17.002), (I-655)+(2.011)+(17.003), (I-655)+(2.011)+(17.008), (I-655)+(2.011)+(18.001),

(I-655)+(2.012)+(3.003), (I-655)+(2.012)+(3.007), (I-655)+(2.012)+(3.012), (I-655)+(2.012)+(3.013), (I-655)+(2.012)+(3.016), (I-655)+(2.012)+(3.017), (I-655)+(2.012)+(3.020), (I-655)+(2.012)+(3.025), (I-655)+(2.012)+(3.026), (I-655)+(2.012)+(3.030), (I-655)+(2.012)+(3.031), (I-655)+(2.012)+(5.003), (I-655)+(2.012)+(5.004), (I-655)+(2.012)+(5.005), (I-655)+(2.012)+(5.008), (I-655)+(2.012)+(5.009), (I-655)+(2.012)+(5.011), (I-655)+(2.012)+(5.012), (I-655)+(2.012)+(5.013), (I-655)+(2.012)+(5.015), (I-655)+(2.012)+(5.018), (I-655)+(2.012)+(5.019), (I-655)+(2.012)+(6.002), (I-655)+(2.012)+(7.001), (I-655)+(2.012)+(7.005), (I-655)+(2.012)+(9.002), (I-655)+(2.012)+(9.004), (I-655)+(2.012)+(14.001), (I-655)+(2.012)+(14.002), (I-655)+(2.012)+(15.008), (I-655)+(2.012)+(15.011), (I-655)+(2.012)+(15.012), (I-655)+(2.012)+(15.016), (I-655)+(2.012)+(15.025), (I-655)+(2.012)+(15.027), (I-655)+(2.012)+(15.047), (I-655)+(2.012)+(15.063), (I-655)+(2.012)+(15.064), (I-655)+(2.012)+(16.001), (I-655)+(2.012)+(16.005), (I-655)+(2.012)+(17.001), (I-655)+(2.012)+(17.002), (I-655)+(2.012)+(17.003), (I-655)+(2.012)+(17.008), (I-655)+(2.012)+(18.001),

(I-655)+(2.013)+(3.003), (I-655)+(2.013)+(3.007), (I-655)+(2.013)+(3.012), (I-655)+(2.013)+(3.013), (I-655)+(2.013)+(3.016), (I-655)+(2.013)+(3.017), (I-655)+(2.013)+(3.020), (I-655)+(2.013)+(3.025), (I-655)+(2.013)+(3.026), (I-655)+(2.013)+(3.030), (I-655)+(2.013)+(3.031), (I-655)+(2.013)+(5.003), (I-655)+(2.013)+(5.004), (I-655)+(2.013)+(5.005), (I-655)+(2.013)+(5.008), (I-655)+(2.013)+(5.009), (I-655)+(2.013)+(5.011), (I-655)+(2.013)+(5.012), (I-655)+(2.013)+(5.013), (I-655)+(2.013)+(5.015), (I-655)+(2.013)+(5.018), (I-655)+(2.013)+(5.019), (I-655)+(2.013)+(6.002), (I-655)+(2.013)+(7.001), (I-655)+(2.013)+(7.005), (I-655)+(2.013)+(9.002), (I-655)+(2.013)+(9.004), (I-655)+(2.013)+(14.001), (I-655)+(2.013)+(14.002), (I-655)+(2.013)+(15.008), (I-655)+(2.013)+(15.011), (I-655)+(2.013)+(15.012), (I-655)+(2.013)+(15.016), (I-655)+(2.013)+(15.025), (I-655)+(2.013)+(15.027), (I-655)+(2.013)+(15.047), (I-655)+(2.013)+(15.063), (I-655)+(2.013)+(15.064), (I-655)+(2.013)+(16.001), (I-655)+(2.013)+(16.005), (I-655)+(2.013)+(17.001), (I-655)+(2.013)+(17.002), (I-655)+(2.013)+(17.003), (I-655)+(2.013)+(17.008), (I-655)+(2.013)+(18.001),

(I-655)+(2.014)+(3.003), (I-655)+(2.014)+(3.007), (I-655)+(2.014)+(3.012), (I-655)+(2.014)+(3.013), (I-655)+(2.014)+(3.016), (I-655)+(2.014)+(3.017), (I-655)+(2.014)+(3.020), (I-655)+(2.014)+(3.025), (I-655)+(2.014)+(3.026), (I-655)+(2.014)+(3.030), (I-655)+(2.014)+(3.031), (I-655)+(2.014)+(5.003), (I-655)+(2.014)+(5.004), (I-655)+(2.014)+(5.005), (I-655)+(2.014)+(5.008), (I-655)+(2.014)+(5.009), (I-655)+(2.014)+(5.011), (I-655)+(2.014)+(5.012), (I-655)+(2.014)+(5.013), (I-655)+(2.014)+(5.015), (I-655)+(2.014)+(5.018), (I-655)+(2.014)+(5.019), (I-655)+(2.014)+(6.002), (I-655)+(2.014)+(7.001), (I-655)+(2.014)+(7.005), (I-655)+(2.014)+(9.002), (I-655)+(2.014)+(9.004), (I-655)+(2.014)+(14.001), (I-655)+(2.014)+(14.002), (I-655)+(2.014)+(15.008), (I-655)+(2.014)+(15.011), (I-655)+(2.014)+(15.012), (I-655)+(2.014)+(15.016), (I-655)+(2.014)+(15.025), (I-655)+(2.014)+(15.027), (I-655)+(2.014)+(15.047), (I-655)+(2.014)+(15.063), (I-655)+(2.014)+(15.064), (I-655)+(2.014)+(16.001), (I-655)+(2.014)+(16.005), (I-655)+(2.014)+(17.001), (I-655)+(2.014)+(17.002), (I-655)+(2.014)+(17.003), (I-655)+(2.014)+(17.008), (I-655)+(2.014)+(18.001),

(I-655)+(2.015)+(3.003), (I-655)+(2.015)+(3.007), (I-655)+(2.015)+(3.012), (I-655)+(2.015)+(3.013), (I-655)+(2.015)+(3.016), (I-655)+(2.015)+(3.017), (I-655)+(2.015)+(3.020), (I-655)+(2.015)+(3.025), (I-655)+(2.015)+(3.026), (I-655)+(2.015)+(3.030), (I-655)+(2.015)+(3.031), (I-655)+(2.015)+(5.003), (I-655)+(2.015)+(5.004), (I-655)+(2.015)+(5.005), (I-655)+(2.015)+(5.008), (I-655)+(2.015)+(5.009), (I-655)+(2.015)+(5.011), (I-655)+(2.015)+(5.012), (I-655)+(2.015)+(5.013), (I-655)+(2.015)+(5.015), (I-655)+(2.015)+(5.018), (I-655)+(2.015)+(5.019), (I-655)+(2.015)+(6.002), (I-655)+(2.015)+(7.001), (I-655)+(2.015)+(7.005), (I-655)+(2.015)+(9.002), (I-655)+(2.015)+(9.004), (I-655)+(2.015)+(14.001), (I-655)+(2.015)+(14.002), (I-655)+(2.015)+(15.008), (I-655)+(2.015)+(15.011), (I-655)+(2.015)+(15.012), (I-655)+(2.015)+(15.016), (I-655)+(2.015)+(15.025), (I-655)+(2.015)+(15.027), (I-655)+(2.015)+(15.047), (I-655)+(2.015)+(15.063), (I-655)+(2.015)+(15.064), (I-655)+(2.015)+(16.001), (I-655)+(2.015)+(16.005), (I-655)+(2.015)+(17.001), (I-655)+(2.015)+(17.002), (I-655)+(2.015)+(17.003), (I-655)+(2.015)+(17.008), (I-655)+(2.015)+(18.001),

(I-655)+(2.016)+(3.003), (I-655)+(2.016)+(3.007), (I-655)+(2.016)+(3.012), (I-655)+(2.016)+(3.013), (I-655)+(2.016)+(3.016), (I-655)+(2.016)+(3.017), (I-655)+(2.016)+(3.020), (I-655)+(2.016)+(3.025), (I-655)+(2.016)+(3.026), (I-655)+(2.016)+(3.030), (I-655)+(2.016)+(3.031), (I-655)+(2.016)+(5.003), (I-655)+(2.016)+(5.004), (I-655)+(2.016)+(5.005), (I-655)+(2.016)+(5.008), (I-655)+(2.016)+(5.009), (I-655)+(2.016)+(5.011), (I-655)+(2.016)+(5.012), (I-655)+(2.016)+(5.013), (I-655)+(2.016)+(5.015), (I-655)+(2.016)+(5.018), (I-655)+(2.016)+(5.019), (I-655)+(2.016)+(6.002), (I-655)+(2.016)+(7.001), (I-655)+(2.016)+(7.005), (I-655)+(2.016)+(9.002), (I-655)+(2.016)+(9.004), (I-655)+(2.016)+(14.001), (I-655)+(2.016)+(14.002), (I-655)+(2.016)+(15.008), (I-655)+(2.016)+(15.011), (I-655)+(2.016)+(15.012), (I-655)+(2.016)+(15.016), (I-655)+(2.016)+(15.025), (I-655)+(2.016)+(15.027), (I-655)+(2.016)+(15.047), (I-655)+(2.016)+(15.063), (I-655)+(2.016)+(15.064), (I-655)+(2.016)+(16.001), (I-655)+(2.016)+(16.005), (I-655)+(2.016)+(17.001), (I-655)+(2.016)+(17.002), (I-655)+(2.016)+(17.003), (I-655)+(2.016)+(17.008), (I-655)+(2.016)+(18.001),

(I-655)+(2.017)+(3.003), (I-655)+(2.017)+(3.007), (I-655)+(2.017)+(3.012), (I-655)+(2.017)+(3.013), (I-655)+(2.017)+(3.016), (I-655)+(2.017)+(3.017), (I-655)+(2.017)+(3.020), (I-655)+(2.017)+(3.025), (I-655)+(2.017)+(3.026), (I-655)+(2.017)+(3.030), (I-655)+(2.017)+(3.031), (I-655)+(2.017)+(5.003), (I-655)+(2.017)+(5.004), (I-655)+(2.017)+(5.005), (I-655)+(2.017)+(5.008), (I-655)+(2.017)+(5.009), (I-655)+(2.017)+(5.011), (I-655)+(2.017)+(5.012), (I-655)+(2.017)+(5.013), (I-655)+(2.017)+(5.015), (I-655)+(2.017)+(5.018), (I-655)+(2.017)+(5.019), (I-655)+(2.017)+(6.002), (I-655)+(2.017)+(7.001), (I-655)+(2.017)+(7.005), (I-655)+(2.017)+(9.002), (I-655)+(2.017)+(9.004), (I-655)+(2.017)+(14.001), (I-655)+(2.017)+(14.002), (I-655)+(2.017)+(15.008), (I-655)+(2.017)+(15.011), (I-655)+(2.017)+(15.012), (I-655)+(2.017)+(15.016), (I-655)+(2.017)+(15.025), (I-655)+(2.017)+(15.027), (I-655)+(2.017)+(15.047), (I-655)+(2.017)+(15.063), (I-655)+(2.017)+(15.064), (I-655)+(2.017)+(16.001), (I-655)+(2.017)+(16.005), (I-655)+(2.017)+(17.001), (I-655)+(2.017)+(17.002), (I-655)+(2.017)+(17.003), (I-655)+(2.017)+(17.008), (I-655)+(2.017)+(18.001),

(I-655)+(2.018)+(3.003), (I-655)+(2.018)+(3.007), (I-655)+(2.018)+(3.012), (I-655)+(2.018)+(3.013), (I-655)+(2.018)+(3.016), (I-655)+(2.018)+(3.017), (I-655)+(2.018)+(3.020), (I-655)+(2.018)+(3.025), (I-655)+(2.018)+(3.026), (I-655)+(2.018)+(3.030), (I-655)+(2.018)+(3.031), (I-655)+(2.018)+(5.003), (I-655)+(2.018)+(5.004), (I-655)+(2.018)+(5.005), (I-655)+(2.018)+(5.008), (I-655)+(2.018)+(5.009), (I-655)+(2.018)+(5.011), (I-655)+(2.018)+(5.012), (I-655)+(2.018)+(5.013), (I-655)+(2.018)+(5.015), (I-655)+(2.018)+(5.018), (I-655)+(2.018)+(5.019), (I-655)+(2.018)+(6.002), (I-655)+(2.018)+(7.001), (I-655)+(2.018)+(7.005), (I-655)+(2.018)+(9.002), (I-655)+(2.018)+(9.004), (I-655)+(2.018)+(14.001), (I-655)+(2.018)+(14.002), (I-655)+(2.018)+(15.008), (I-655)+(2.018)+(15.011), (I-655)+(2.018)+(15.012), (I-655)+(2.018)+(15.016), (I-655)+(2.018)+(15.025), (I-655)+(2.018)+(15.027), (I-655)+(2.018)+(15.047), (I-655)+(2.018)+(15.063), (I-655)+(2.018)+(15.064), (I-655)+(2.018)+(16.001), (I-655)+(2.018)+(16.005), (I-655)+(2.018)+(17.001), (I-655)+(2.018)+(17.002), (I-655)+(2.018)+(17.003), (I-655)+(2.018)+(17.008), (I-655)+(2.018)+(18.001),

(I-655)+(2.019)+(3.003), (I-655)+(2.019)+(3.007), (I-655)+(2.019)+(3.012), (I-655)+(2.019)+(3.013), (I-655)+(2.019)+(3.016), (I-655)+(2.019)+(3.017), (I-655)+(2.019)+(3.020), (I-655)+(2.019)+(3.025), (I-655)+(2.019)+(3.026), (I-655)+(2.019)+(3.030), (I-655)+(2.019)+(3.031), (I-655)+(2.019)+(5.003), (I-655)+(2.019)+(5.004), (I-655)+(2.019)+(5.005), (I-655)+(2.019)+(5.008), (I-655)+(2.019)+(5.009), (I-655)+(2.019)+(5.011), (I-655)+(2.019)+(5.012), (I-655)+(2.019)+(5.013), (I-655)+(2.019)+(5.015), (I-655)+(2.019)+(5.018), (I-655)+(2.019)+(5.019), (I-655)+(2.019)+(6.002), (I-655)+(2.019)+(7.001), (I-655)+(2.019)+(7.005), (I-655)+(2.019)+(9.002), (I-655)+(2.019)+(9.004), (I-655)+(2.019)+(14.001), (I-655)+(2.019)+(14.002), (I-655)+(2.019)+(15.008), (I-655)+(2.019)+(15.011), (I-655)+(2.019)+(15.012), (I-655)+(2.019)+(15.016), (I-655)+(2.019)+(15.025), (I-655)+(2.019)+(15.027), (I-655)+(2.019)+(15.047), (I-655)+(2.019)+(15.063), (I-655)+(2.019)+(15.064), (I-655)+(2.019)+(16.001), (I-655)+(2.019)+(16.005), (I-655)+(2.019)+(17.001), (I-655)+(2.019)+(17.002), (I-655)+(2.019)+(17.003), (I-655)+(2.019)+(17.008), (I-655)+(2.019)+(18.001),

(I-655)+(2.021)+(3.003), (I-655)+(2.021)+(3.007), (I-655)+(2.021)+(3.012), (I-655)+(2.021)+(3.013), (I-655)+(2.021)+(3.016), (I-655)+(2.021)+(3.017), (I-655)+(2.021)+(3.020), (I-655)+(2.021)+(3.025), (I-655)+(2.021)+(3.026), (I-655)+(2.021)+(3.030), (I-655)+(2.021)+(3.031), (I-655)+(2.021)+(5.003), (I-655)+(2.021)+(5.004), (I-655)+(2.021)+(5.005), (I-655)+(2.021)+(5.008), (I-655)+(2.021)+(5.009), (I-655)+(2.021)+(5.011), (I-655)+(2.021)+(5.012), (I-655)+(2.021)+(5.013), (I-655)+(2.021)+(5.015), (I-655)+(2.021)+(5.018), (I-655)+(2.021)+(5.019), (I-655)+(2.021)+(6.002), (I-655)+(2.021)+(7.001), (I-655)+(2.021)+(7.005), (I-655)+(2.021)+(9.002), (I-655)+(2.021)+(9.004), (I-655)+(2.021)+(14.001), (I-655)+(2.021)+(14.002), (I-655)+(2.021)+(15.008), (I-655)+(2.021)+(15.011), (I-655)+(2.021)+(15.012), (I-655)+(2.021)+(15.016), (I-655)+(2.021)+(15.025), (I-655)+(2.021)+(15.027), (I-655)+(2.021)+(15.047), (I-655)+(2.021)+(15.063), (I-655)+(2.021)+(15.064), (I-655)+(2.021)+(16.001), (I-655)+(2.021)+(16.005), (I-655)+(2.021)+(17.001), (I-655)+(2.021)+(17.002), (I-655)+(2.021)+(17.003), (I-655)+(2.021)+(17.008), (I-655)+(2.021)+(18.001),

(I-655)+(2.028)+(3.003), (I-655)+(2.028)+(3.007), (I-655)+(2.028)+(3.012), (I-655)+(2.028)+(3.013), (I-655)+(2.028)+(3.016), (I-655)+(2.028)+(3.017), (I-655)+(2.028)+(3.020), (I-655)+(2.028)+(3.025), (I-655)+(2.028)+(3.026), (I-655)+(2.028)+(3.030), (I-655)+(2.028)+(3.031), (I-655)+(2.028)+(5.003), (I-655)+(2.028)+(5.004), (I-655)+(2.028)+(5.005), (I-655)+(2.028)+(5.008), (I-655)+(2.028)+(5.009), (I-655)+(2.028)+(5.011), (I-655)+(2.028)+(5.012), (I-655)+(2.028)+(5.013), (I-655)+(2.028)+(5.015), (I-655)+(2.028)+(5.018), (I-655)+(2.028)+(5.019), (I-655)+(2.028)+(6.002), (I-655)+(2.028)+(7.001), (I-655)+(2.028)+(7.005), (I-655)+(2.028)+(9.002), (I-655)+(2.028)+(9.004), (I-655)+(2.028)+(14.001), (I-655)+(2.028)+(14.002), (I-655)+(2.028)+(15.008), (I-655)+(2.028)+(15.011), (I-655)+(2.028)+(15.012), (I-655)+(2.028)+(15.016), (I-655)+(2.028)+(15.025), (I-655)+(2.028)+(15.027), (I-655)+(2.028)+(15.047), (I-655)+(2.028)+(15.063), (I-655)+(2.028)+(15.064), (I-655)+(2.028)+(16.001), (I-655)+(2.028)+(16.005), (I-655)+(2.028)+(17.001), (I-655)+(2.028)+(17.002), (I-655)+(2.028)+(17.003), (I-655)+(2.028)+(17.008), (I-655)+(2.028)+(18.001),

(I-655)+(2.030)+(3.003), (I-655)+(2.030)+(3.007), (I-655)+(2.030)+(3.012), (I-655)+(2.030)+(3.013), (I-655)+(2.030)+(3.016), (I-655)+(2.030)+(3.017), (I-655)+(2.030)+(3.020), (I-655)+(2.030)+(3.025), (I-655)+(2.030)+(3.026), (I-655)+(2.030)+(3.030), (I-655)+(2.030)+(3.031), (I-655)+(2.030)+(5.003), (I-655)+(2.030)+(5.004), (I-655)+(2.030)+(5.005), (I-655)+(2.030)+(5.008), (I-655)+(2.030)+(5.009), (I-655)+(2.030)+(5.011), (I-655)+(2.030)+(5.012), (I-655)+(2.030)+(5.013), (I-655)+(2.030)+(5.015), (I-655)+(2.030)+(5.018), (I-655)+(2.030)+(5.019), (I-655)+(2.030)+(6.002), (I-655)+(2.030)+(7.001), (I-655)+(2.030)+(7.005), (I-655)+(2.030)+(9.002), (I-655)+(2.030)+(9.004), (I-655)+(2.030)+(14.001), (I-655)+(2.030)+(14.002), (I-655)+(2.030)+(15.008), (I-655)+(2.030)+(15.011), (I-655)+(2.030)+(15.012), (I-655)+(2.030)+(15.016), (I-655)+(2.030)+(15.025), (I-655)+(2.030)+(15.027), (I-655)+(2.030)+(15.047), (I-655)+(2.030)+(15.063), (I-655)+(2.030)+(15.064), (I-655)+(2.030)+(16.001), (I-655)+(2.030)+(16.005), (I-655)+(2.030)+(17.001), (I-655)+(2.030)+(17.002), (I-655)+(2.030)+(17.003), (I-655)+(2.030)+(17.008), (I-655)+(2.030)+(18.001),

(I-655)+(2.038)+(3.003), (I-655)+(2.038)+(3.007), (I-655)+(2.038)+(3.012), (I-655)+(2.038)+(3.013), (I-655)+(2.038)+(3.016), (I-655)+(2.038)+(3.017), (I-655)+(2.038)+(3.020), (I-655)+(2.038)+(3.025), (I-655)+(2.038)+(3.026), (I-655)+(2.038)+(3.030), (I-655)+(2.038)+(3.031), (I-655)+(2.038)+(5.003), (I-655)+(2.038)+(5.004), (I-655)+(2.038)+(5.005), (I-655)+(2.038)+(5.008), (I-655)+(2.038)+(5.009), (I-655)+(2.038)+(5.011), (I-655)+(2.038)+(5.012), (I-655)+(2.038)+(5.013), (I-655)+(2.038)+(5.015), (I-655)+(2.038)+(5.018), (I-655)+(2.038)+(5.019), (I-655)+(2.038)+(6.002), (I-655)+(2.038)+(7.001), (I-655)+(2.038)+(7.005), (I-655)+(2.038)+(9.002), (I-655)+(2.038)+(9.004), (I-655)+(2.038)+(14.001), (I-655)+(2.038)+(14.002), (I-655)+(2.038)+(15.008), (I-655)+(2.038)+(15.011), (I-655)+(2.038)+(15.012), (I-655)+(2.038)+(15.016), (I-655)+(2.038)+(15.025), (I-655)+(2.038)+(15.027), (I-655)+(2.038)+(15.047), (I-655)+(2.038)+(15.063), (I-655)+(2.038)+(15.064), (I-655)+(2.038)+(16.001), (I-655)+(2.038)+(16.005), (I-655)+(2.038)+(17.001), (I-655)+(2.038)+(17.002), (I-655)+(2.038)+(17.003), (I-655)+(2.038)+(17.008), (I-655)+(2.038)+(18.001).

(I-655)+(3.003)+(3.025), (I-655)+(3.003)+(3.030), (I-655)+(3.003)+(3.031), (I-655)+(3.003)+(5.003), (I-655)+(3.003)+(5.004), (I-655)+(3.003)+(5.005), (I-655)+(3.003)+(5.008), (I-655)+(3.003)+(5.009), (I-655)+(3.003)+(5.011), (I-655)+(3.003)+(5.012), (I-655)+(3.003)+(5.013), (I-655)+(3.003)+(5.015), (I-655)+(3.003)+(5.018), (I-655)+(3.003)+(5.019), (I-655)+(3.003)+(6.002), (I-655)+(3.003)+(7.001), (I-655)+(3.003)+(7.005), (I-655)+(3.003)+(9.002), (I-655)+(3.003)+(9.004), (I-655)+(3.003)+(14.001), (I-655)+(3.003)+(14.002), (I-655)+(3.003)+(15.008), (I-655)+(3.003)+(15.011), (I-655)+(3.003)+(15.012), (I-655)+(3.003)+(15.016), (I-655)+(3.003)+(15.025), (I-655)+(3.003)+(15.027), (I-655)+(3.003)+(15.047), (I-655)+(3.003)+(15.063), (I-655)+(3.003)+(15.064), (I-655)+(3.003)+(16.001), (I-655)+(3.003)+(16.005), (I-655)+(3.003)+(17.001), (I-655)+(3.003)+(17.002), (I-655)+(3.003)+(17.003), (I-655)+(3.003)+(17.008), (I-655)+(3.003)+(18.001),

(I-655)+(3.007)+(3.025), (I-655)+(3.007)+(3.030), (I-655)+(3.007)+(3.031), (I-655)+(3.007)+(5.003), (I-655)+(3.007)+(5.004), (I-655)+(3.007)+(5.005), (I-655)+(3.007)+(5.008), (I-655)+(3.007)+(5.009), (I-655)+(3.007)+(5.011), (I-655)+(3.007)+(5.012), (I-655)+(3.007)+(5.013), (I-655)+(3.007)+(5.015), (I-655)+(3.007)+(5.018), (I-655)+(3.007)+(5.019), (I-655)+(3.007)+(6.002), (I-655)+(3.007)+(7.001), (I-655)+(3.007)+(7.005), (I-655)+(3.007)+(9.002), (I-655)+(3.007)+(9.004), (I-655)+(3.007)+(14.001), (I-655)+(3.007)+(14.002), (I-655)+(3.007)+(15.008), (I-655)+(3.007)+(15.011), (I-655)+(3.007)+(15.012), (I-655)+(3.007)+(15.016), (I-655)+(3.007)+(15.025), (I-655)+(3.007)+(15.027), (I-655)+(3.007)+(15.047), (I-655)+(3.007)+(15.063), (I-655)+(3.007)+(15.064),

(I-655)+(3.007)+(16.001), (I-655)+(3.007)+(16.005), (I-655)+(3.007)+(17.001), (I-655)+(3.007)+(17.002), (I-655)+(3.007)+(17.003), (I-655)+(3.007)+(17.008), (I-655)+(3.007)+(18.001),

(I-655)+(3.012)+(3.025), (I-655)+(3.012)+(3.030), (I-655)+(3.012)+(3.031), (I-655)+(3.012)+(5.003), (I-655)+(3.012)+(5.004), (I-655)+(3.012)+(5.005), (I-655)+(3.012)+(5.008), (I-655)+(3.012)+(5.009), (I-655)+(3.012)+(5.011), (I-655)+(3.012)+(5.012), (I-655)+(3.012)+(5.013), (I-655)+(3.012)+(5.015), (I-655)+(3.012)+(5.018), (I-655)+(3.012)+(5.019), (I-655)+(3.012)+(6.002), (I-655)+(3.012)+(7.001), (I-655)+(3.012)+(7.005), (I-655)+(3.012)+(9.002), (I-655)+(3.012)+(9.004), (I-655)+(3.012)+(14.001), (I-655)+(3.012)+(14.002), (I-655)+(3.012)+(15.008), (I-655)+(3.012)+(15.011), (I-655)+(3.012)+(15.012), (I-655)+(3.012)+(15.016), (I-655)+(3.012)+(15.025), (I-655)+(3.012)+(15.027), (I-655)+(3.012)+(15.047), (I-655)+(3.012)+(15.063), (I-655)+(3.012)+(15.064), (I-655)+(3.012)+(16.001), (I-655)+(3.012)+(16.005), (I-655)+(3.012)+(17.001), (I-655)+(3.012)+(17.002), (I-655)+(3.012)+(17.003), (I-655)+(3.012)+(17.008), (I-655)+(3.012)+(18.001),

(I-655)+(3.013)+(3.025), (I-655)+(3.013)+(3.030), (I-655)+(3.013)+(3.031), (I-655)+(3.013)+(5.003), (I-655)+(3.013)+(5.004), (I-655)+(3.013)+(5.005), (I-655)+(3.013)+(5.008), (I-655)+(3.013)+(5.009), (I-655)+(3.013)+(5.011), (I-655)+(3.013)+(5.012), (I-655)+(3.013)+(5.013), (I-655)+(3.013)+(5.015), (I-655)+(3.013)+(5.018), (I-655)+(3.013)+(5.019), (I-655)+(3.013)+(6.002), (I-655)+(3.013)+(7.001), (I-655)+(3.013)+(7.005), (I-655)+(3.013)+(9.002), (I-655)+(3.013)+(9.004), (I-655)+(3.013)+(14.001), (I-655)+(3.013)+(14.002), (I-655)+(3.013)+(15.008), (I-655)+(3.013)+(15.011), (I-655)+(3.013)+(15.012), (I-655)+(3.013)+(15.016), (I-655)+(3.013)+(15.025), (I-655)+(3.013)+(15.027), (I-655)+(3.013)+(15.047), (I-655)+(3.013)+(15.063), (I-655)+(3.013)+(15.064), (I-655)+(3.013)+(16.001), (I-655)+(3.013)+(16.005), (I-655)+(3.013)+(17.001), (I-655)+(3.013)+(17.002), (I-655)+(3.013)+(17.003), (I-655)+(3.013)+(17.008), (I-655)+(3.013)+(18.001),

(I-655)+(3.016)+(3.025), (I-655)+(3.016)+(3.030), (I-655)+(3.016)+(3.031), (I-655)+(3.016)+(5.003), (I-655)+(3.016)+(5.004), (I-655)+(3.016)+(5.005), (I-655)+(3.016)+(5.008), (I-655)+(3.016)+(5.009), (I-655)+(3.016)+(5.011), (I-655)+(3.016)+(5.012), (I-655)+(3.016)+(5.013), (I-655)+(3.016)+(5.015), (I-655)+(3.016)+(5.018), (I-655)+(3.016)+(5.019), (I-655)+(3.016)+(6.002), (I-655)+(3.016)+(7.001), (I-655)+(3.016)+(7.005), (I-655)+(3.016)+(9.002), (I-655)+(3.016)+(9.004), (I-655)+(3.016)+(14.001), (I-655)+(3.016)+(14.002), (I-655)+(3.016)+(15.008), (I-655)+(3.016)+(15.011), (I-655)+(3.016)+(15.012), (I-655)+(3.016)+(15.016), (I-655)+(3.016)+(15.025), (I-655)+(3.016)+(15.027), (I-655)+(3.016)+(15.047), (I-655)+(3.016)+(15.063), (I-655)+(3.016)+(15.064), (I-655)+(3.016)+(16.001), (I-655)+(3.016)+(16.005), (I-655)+(3.016)+(17.001), (I-655)+(3.016)+(17.002), (I-655)+(3.016)+(17.003), (I-655)+(3.016)+(17.008), (I-655)+(3.016)+(18.001),

(I-655)+(3.017)+(3.025), (I-655)+(3.017)+(3.030), (I-655)+(3.017)+(3.031), (I-655)+(3.017)+(5.003), (I-655)+(3.017)+(5.004), (I-655)+(3.017)+(5.005), (I-655)+(3.017)+(5.008), (I-655)+(3.017)+(5.009), (I-655)+(3.017)+(5.011), (I-655)+(3.017)+(5.012), (I-655)+(3.017)+(5.013), (I-655)+(3.017)+(5.015), (I-655)+(3.017)+(5.018), (I-655)+(3.017)+(5.019), (I-655)+(3.017)+(6.002), (I-655)+(3.017)+(7.001), (I-655)+(3.017)+(7.005), (I-655)+(3.017)+(9.002), (I-655)+(3.017)+(9.004), (I-655)+(3.017)+(14.001), (I-655)+(3.017)+(14.002), (I-655)+(3.017)+(15.008), (I-655)+(3.017)+(15.011), (I-655)+(3.017)+(15.012), (I-655)+(3.017)+(15.016), (I-655)+(3.017)+(15.025), (I-655)+(3.017)+(15.027), (I-655)+(3.017)+(15.047), (I-655)+(3.017)+(15.063), (I-655)+(3.017)+(15.064), (I-655)+(3.017)+(16.001), (I-655)+(3.017)+(16.005), (I-655)+(3.017)+(17.001), (I-655)+(3.017)+(17.002), (I-655)+(3.017)+(17.003), (I-655)+(3.017)+(17.008), (I-655)+(3.017)+(18.001),

(I-655)+(3.020)+(3.025), (I-655)+(3.020)+(3.030), (I-655)+(3.020)+(3.031), (I-655)+(3.020)+(5.003), (I-655)+(3.020)+(5.004), (I-655)+(3.020)+(5.005), (I-655)+(3.020)+(5.008), (I-655)+(3.020)+(5.009), (I-655)+(3.020)+(5.011), (I-655)+(3.020)+(5.012), (I-655)+(3.020)+(5.013), (I-655)+(3.020)+(5.015), (I-655)+(3.020)+(5.018), (I-655)+(3.020)+(5.019), (I-655)+(3.020)+(6.002), (I-655)+(3.020)+(7.001), (I-655)+(3.020)+(7.005), (I-655)+(3.020)+(9.002), (I-655)+(3.020)+(9.004), (I-655)+(3.020)+(14.001), (I-655)+(3.020)+(14.002), (I-655)+(3.020)+(15.008), (I-655)+(3.020)+(15.011), (I-655)+(3.020)+(15.012), (I-655)+(3.020)+(15.016), (I-655)+(3.020)+(15.025), (I-655)+(3.020)+(15.027), (I-655)+(3.020)+(15.047), (I-655)+(3.020)+(15.063), (I-655)+(3.020)+(15.064), (I-655)+(3.020)+(16.001), (I-655)+(3.020)+(16.005), (I-655)+(3.020)+(17.001), (I-655)+(3.020)+(17.002), (I-655)+(3.020)+(17.003), (I-655)+(3.020)+(17.008), (I-655)+(3.020)+(18.001),

(I-655)+(3.025)+(3.030), (I-655)+(3.025)+(3.031), (I-655)+(3.025)+(5.003), (I-655)+(3.025)+(5.004), (I-655)+(3.025)+(5.005), (I-655)+(3.025)+(5.008), (I-655)+(3.025)+(5.009), (I-655)+(3.025)+(5.011), (I-655)+(3.025)+(5.012), (I-655)+(3.025)+(5.013), (I-655)+(3.025)+(5.015), (I-655)+(3.025)+(5.018), (I-655)+(3.025)+(5.019), (I-655)+(3.025)+(6.002), (I-655)+(3.025)+(7.001), (I-655)+(3.025)+(7.005), (I-655)+(3.025)+(9.002), (I-655)+(3.025)+(9.004), (I-655)+(3.025)+(14.001), (I-655)+(3.025)+(14.002), (I-655)+(3.025)+(15.008), (I-655)+(3.025)+(15.011), (I-655)+(3.025)+(15.012), (I-655)+(3.025)+(15.016), (I-655)+(3.025)+(15.025), (I-655)+(3.025)+(15.027), (I-655)+(3.025)+(15.047), (I-655)+(3.025)+(15.063), (I-655)+(3.025)+(15.064), (I-655)+(3.025)+(16.001), (I-655)+(3.025)+(16.005), (I-655)+(3.025)+(17.001), (I-655)+(3.025)+(17.002), (I-655)+(3.025)+(17.003), (I-655)+(3.025)+(17.008), (I-655)+(3.025)+(18.001),

(I-655)+(3.026)+(3.025), (I-655)+(3.026)+(3.030), (I-655)+(3.026)+(3.031), (I-655)+(3.026)+(5.003), (I-655)+(3.026)+(5.004), (I-655)+(3.026)+(5.005), (I-655)+(3.026)+(5.008), (I-655)+(3.026)+(5.009), (I-655)+(3.026)+(5.011), (I-655)+(3.026)+(5.012), (I-655)+(3.026)+(5.013), (I-655)+(3.026)+(5.015), (I-655)+(3.026)+(5.018), (I-655)+(3.026)+(5.019), (I-655)+(3.026)+(6.002), (I-655)+(3.026)+(7.001), (I-655)+(3.026)+(7.005), (I-655)+(3.026)+(9.002), (I-655)+(3.026)+(9.004), (I-655)+(3.026)+(14.001), (I-655)+(3.026)+(14.002), (I-655)+(3.026)+(15.008), (I-655)+(3.026)+(15.011), (I-655)+(3.026)+(15.012), (I-655)+(3.026)+(15.016), (I-655)+(3.026)+(15.025), (I-655)+(3.026)+(15.027), (I-655)+(3.026)+(15.047), (I-655)+(3.026)+(15.063), (I-655)+(3.026)+(15.064), (I-655)+(3.026)+(16.001), (I-655)+(3.026)+(16.005), (I-655)+(3.026)+(17.001), (I-655)+(3.026)+(17.002), (I-655)+(3.026)+(17.003), (I-655)+(3.026)+(17.008), (I-655)+(3.026)+(18.001),

(I-655)+(3.030)+(3.025), (I-655)+(3.030)+(3.031), (I-655)+(3.030)+(5.003), (I-655)+(3.030)+(5.004), (I-655)+(3.030)+(5.005), (I-655)+(3.030)+(5.008), (I-655)+(3.030)+(5.009), (I-655)+(3.030)+(5.011), (I-655)+(3.030)+(5.012), (I-655)+(3.030)+(5.013), (I-655)+(3.030)+(5.015), (I-655)+(3.030)+(5.018), (I-655)+(3.030)+(5.019), (I-655)+(3.030)+(6.002), (I-655)+(3.030)+(7.001), (I-655)+(3.030)+(7.005), (I-655)+(3.030)+(9.002), (I-655)+(3.030)+(9.004), (I-655)+(3.030)+(14.001), (I-655)+(3.030)+(14.002), (I-655)+(3.030)+(15.008), (I-655)+(3.030)+(15.011), (I-655)+(3.030)+(15.012), (I-655)+(3.030)+(15.016), (I-655)+(3.030)+(15.025), (I-655)+(3.030)+(15.027), (I-655)+(3.030)+(15.047), (I-655)+(3.030)+(15.063), (I-655)+(3.030)+(15.064), (I-655)+(3.030)+(16.001), (I-655)+(3.030)+(16.005), (I-655)+(3.030)+(17.001), (I-655)+(3.030)+(17.002), (I-655)+(3.030)+(17.003), (I-655)+(3.030)+(17.008), (I-655)+(3.030)+(18.001),

(I-655)+(3.031)+(3.025), (I-655)+(3.031)+(3.030), (I-655)+(3.031)+(5.003), (I-655)+(3.031)+(5.004), (I-655)+(3.031)+(5.005), (I-655)+(3.031)+(5.008), (I-655)+(3.031)+(5.009), (I-655)+(3.031)+(5.011), (I-655)+(3.031)+(5.012), (I-655)+(3.031)+(5.013), (I-655)+(3.031)+(5.015), (I-655)+(3.031)+(5.018), (I-655)+(3.031)+(5.019), (I-655)+(3.031)+(6.002), (I-655)+(3.031)+(7.001), (I-655)+(3.031)+(7.005), (I-655)+(3.031)+(9.002), (I-655)+(3.031)+(9.004), (I-655)+(3.031)+(14.001), (I-655)+(3.031)+(14.002), (I-655)+(3.031)+(15.008), (I-655)+(3.031)+(15.011), (I-655)+(3.031)+(15.012), (I-655)+(3.031)+(15.016), (I-655)+(3.031)+(15.025), (I-655)+(3.031)+(15.027), (I-655)+(3.031)+(15.047), (I-655)+(3.031)+(15.063), (I-655)+(3.031)+(15.064), (I-655)+(3.031)+(16.001), (I-655)+(3.031)+(16.005), (I-655)+(3.031)+(17.001), (I-655)+(3.031)+(17.002), (I-655)+(3.031)+(17.003), (I-655)+(3.031)+(17.008), (I-655)+(3.031)+(18.001),

(I-655)+(5.003)+(9.002), (I-655)+(5.003)+(15.012), (I-655)+(5.003)+(15.016), (I-655)+(5.003)+(15.025), (I-655)+(5.003)+(15.027), (I-655)+(5.003)+(15.047), (I-655)+(5.003)+(15.063), (I-655)+(5.003)+(15.064),

(I-655)+(5.004)+(9.002), (I-655)+(5.004)+(15.012), (I-655)+(5.004)+(15.016), (I-655)+(5.004)+(15.025), (I-655)+(5.004)+(15.027), (I-655)+(5.004)+(15.047), (I-655)+(5.004)+(15.063), (I-655)+(5.004)+(15.064),

(I-655)+(5.005)+(9.002), (I-655)+(5.005)+(15.012), (I-655)+(5.005)+(15.016), (I-655)+(5.005)+(15.025), (I-655)+(5.005)+(15.027), (I-655)+(5.005)+(15.047), (I-655)+(5.005)+(15.063), (I-655)+(5.005)+(15.064),

(I-655)+(5.008)+(9.002), (I-655)+(5.008)+(15.012), (I-655)+(5.008)+(15.016), (I-655)+(5.008)+(15.025), (I-655)+(5.008)+(15.027), (I-655)+(5.008)+(15.047), (I-655)+(5.008)+(15.063), (I-655)+(5.008)+(15.064),

(I-655)+(5.009)+(9.002), (I-655)+(5.009)+(15.012), (I-655)+(5.009)+(15.016), (I-655)+(5.009)+(15.025), (I-655)+(5.009)+(15.027), (I-655)+(5.009)+(15.047), (I-655)+(5.009)+(15.063), (I-655)+(5.009)+(15.064),

(I-655)+(5.011)+(9.002), (I-655)+(5.011)+(15.012), (I-655)+(5.011)+(15.016), (I-655)+(5.011)+(15.025), (I-655)+(5.011)+(15.027), (I-655)+(5.011)+(15.047), (I-655)+(5.011)+(15.063), (I-655)+(5.011)+(15.064),

(I-655)+(5.012)+(9.002), (I-655)+(5.012)+(15.012), (I-655)+(5.012)+(15.016), (I-655)+(5.012)+(15.025), (I-655)+(5.012)+(15.027), (I-655)+(5.012)+(15.047), (I-655)+(5.012)+(15.063), (I-655)+(5.012)+(15.064),

(I-655)+(5.013)+(9.002), (I-655)+(5.013)+(15.012), (I-655)+(5.013)+(15.016), (I-655)+(5.013)+(15.025), (I-655)+(5.013)+(15.027), (I-655)+(5.013)+(15.047), (I-655)+(5.013)+(15.063), (I-655)+(5.013)+(15.064),

(I-655)+(5.015)+(9.002), (I-655)+(5.015)+(15.012), (I-655)+(5.015)+(15.016), (I-655)+(5.015)+(15.025), (I-655)+(5.015)+(15.027), (I-655)+(5.015)+(15.047), (I-655)+(5.015)+(15.063), (I-655)+(5.015)+(15.064),

(I-655)+(5.018)+(9.002), (I-655)+(5.018)+(15.012), (I-655)+(5.018)+(15.016), (I-655)+(5.018)+(15.025), (I-655)+(5.018)+(15.027), (I-655)+(5.018)+(15.047), (I-655)+(5.018)+(15.063), (I-655)+(5.018)+(15.064),

(I-655)+(5.019)+(9.002), (I-655)+(5.019)+(15.012), (I-655)+(5.019)+(15.016), (I-655)+(5.019)+(15.025), (I-655)+(5.019)+(15.027), (I-655)+(5.019)+(15.047), (I-655)+(5.019)+(15.063), (I-655)+(5.019)+(15.064).

If two compounds (B) are present in the combinations according to the invention, more preferred compound combinations are selected from the group (G3-C1) consisting of the following mixtures:

(I-746)+(1.001)+(1.002), (I-746)+(1.001)+(1.003), (I-746)+(1.001)+(1.004), (I-746)+(1.001)+(1.005), (I-746)+(1.001)+(1.006), (I-746)+(1.001)+(1.007), (I-746)+(1.001)+(1.010), (I-746)+(1.001)+(1.011), (I-746)+(1.001)+(1.012), (I-746)+(1.001)+(1.013), (I-746)+(1.001)+(1.017), (I-746)+(1.001)+(1.018), (I-746)+(1.001)+(1.020), (I-746)+(1.001)+(1.021), (I-746)+(1.001)+(1.026), (I-746)+(1.001)+(1.027), (I-746)+(1.001)+(1.055), (I-746)+(1.001)+(1.059), (I-746)+(1.001)+(1.092), (I-746)+(1.001)+(2.001), (I-746)+(1.001)+(2.002), (I-746)+(1.001)+(2.003), (I-746)+(1.001)+(2.005), (I-746)+(1.001)+(2.007), (I-746)+(1.001)+(2.009), (I-746)+(1.001)+(2.010), (I-746)+(1.001)+(2.011), (I-746)+(1.001)+(2.012), (I-746)+(1.001)+(2.013), (I-746)+(1.001)+(2.014), (I-746)+(1.001)+(2.015), (I-746)+(1.001)+(2.016), (I-746)+(1.001)+(2.017), (I-746)+(1.001)+(2.018), (I-746)+(1.001)+(2.019), (I-746)+(1.001)+(2.021), (I-746)+(1.001)+(2.028), (I-746)+(1.001)+(2.030), (I-746)+(1.001)+(2.038), (I-746)+(1.001)+(3.003), (I-746)+(1.001)+(3.007), (I-746)+(1.001)+(3.012), (I-746)+(1.001)+(3.013), (I-746)+(1.001)+(3.016), (I-746)+(1.001)+(3.017), (I-746)+(1.001)+(3.020), (I-746)+(1.001)+(3.025), (I-746)+(1.001)+(3.026), (I-746)+(1.001)+(3.030), (I-746)+(1.001)+(3.031), (I-746)+(1.001)+(5.003), (I-746)+(1.001)+(5.004), (I-746)+(1.001)+(5.005), (I-746)+(1.001)+(5.008), (I-746)+(1.001)+(5.009), (I-746)+(1.001)+(5.011), (I-746)+(1.001)+(5.012), (I-746)+(1.001)+(5.013), (I-746)+(1.001)+(5.015), (I-746)+(1.001)+(5.018), (I-746)+(1.001)+(5.019), (I-746)+(1.001)+(6.002), (I-746)+(1.001)+(7.001), (I-746)+(1.001)+(7.005), (I-746)+(1.001)+(9.002), (I-746)+(1.001)+(9.004), (I-746)+(1.001)+(14.001), (I-746)+(1.001)+(14.002), (I-746)+(1.001)+(15.008), (I-746)+(1.001)+(15.011), (I-746)+(1.001)+(15.012), (I-746)+(1.001)+(15.016), (I-746)+(1.001)+(15.025), (I-746)+(1.001)+(15.027), (I-746)+(1.001)+(15.047), (I-746)+(1.001)+(15.063), (I-746)+(1.001)+(15.064), (I-746)+(1.001)+(16.001), (I-746)+(1.001)+(16.005), (I-746)+(1.001)+(17.001), (I-746)+(1.001)+(17.002), (I-746)+(1.001)+(17.003), (I-746)+(1.001)+(17.008), (I-746)+(1.001)+(18.001),

(I-746)+(1.002)+(1.001), (I-746)+(1.002)+(1.003), (I-746)+(1.002)+(1.004), (I-746)+(1.002)+(1.005), (I-746)+(1.002)+(1.006), (I-746)+(1.002)+(1.007), (I-746)+(1.002)+(1.010), (I-746)+(1.002)+(1.011), (I-746)+(1.002)+(1.012), (I-746)+(1.002)+(1.013), (I-746)+(1.002)+(1.017), (I-746)+(1.002)+(1.018), (I-746)+(1.002)+(1.020), (I-746)+(1.002)+(1.021), (I-746)+(1.002)+(1.026), (I-746)+(1.002)+(1.027), (I-746)+(1.002)+(1.055), (I-746)+(1.002)+(1.059), (I-746)+(1.002)+(1.092), (I-746)+(1.002)+(2.001), (I-746)+(1.002)+(2.002), (I-746)+(1.002)+(2.003), (I-746)+(1.002)+(2.005), (I-746)+(1.002)+(2.007), (I-746)+(1.002)+(2.009), (I-746)+(1.002)+(2.010), (I-746)+(1.002)+(2.011), (I-746)+(1.002)+(2.012), (I-746)+(1.002)+(2.013), (I-746)+(1.002)+(2.014), (I-746)+(1.002)+(2.015), (I-746)+(1.002)+(2.016), (I-746)+(1.002)+(2.017), (I-746)+(1.002)+(2.018), (I-746)+(1.002)+(2.019), (I-746)+(1.002)+(2.021), (I-746)+(1.002)+(2.028), (I-746)+(1.002)+(2.030), (I-746)+(1.002)+(2.038), (I-746)+(1.002)+(3.003), (I-746)+(1.002)+(3.007), (I-746)+(1.002)+(3.012), (I-746)+(1.002)+(3.013), (I-746)+(1.002)+(3.016), (I-746)+(1.002)+(3.017), (I-746)+(1.002)+(3.020), (I-746)+(1.002)+(3.025), (I-746)+(1.002)+(3.026), (I-746)+(1.002)+(3.030), (I-746)+(1.002)+(3.031), (I-746)+(1.002)+(5.003), (I-746)+(1.002)+(5.004), (I-746)+(1.002)+(5.005), (I-746)+(1.002)+(5.008), (I-746)+(1.002)+(5.009), (I-746)+(1.002)+(5.011), (I-746)+(1.002)+(5.012), (I-746)+(1.002)+(5.013), (I-746)+(1.002)+(5.015), (I-746)+(1.002)+(5.018), (I-746)+(1.002)+(5.019), (I-746)+(1.002)+(6.002), (I-746)+(1.002)+(7.001), (I-746)+(1.002)+(7.005), (I-746)+(1.002)+(9.002), (I-746)+(1.002)+(9.004), (I-746)+(1.002)+(14.001), (I-746)+(1.002)+(14.002), (I-746)+(1.002)+(15.008), (I-746)+(1.002)+(15.011), (I-746)+(1.002)+(15.012), (I-746)+(1.002)+(15.016), (I-746)+(1.002)+(15.025), (I-746)+(1.002)+(15.027), (I-746)+(1.002)+(15.047), (I-746)+(1.002)+(15.063), (I-746)+(1.002)+(15.064), (I-746)+(1.002)+(16.001), (I-746)+(1.002)+(16.005), (I-746)+(1.002)+(17.001), (I-746)+(1.002)+(17.002), (I-746)+(1.002)+(17.003), (I-746)+(1.002)+(17.008), (I-746)+(1.002)+(18.001),

(I-746)+(1.003)+(1.001), (I-746)+(1.003)+(1.002), (I-746)+(1.003)+(1.004), (I-746)+(1.003)+(1.005), (I-746)+(1.003)+(1.006), (I-746)+(1.003)+(1.007), (I-746)+(1.003)+(1.010), (I-746)+(1.003)+(1.011), (I-746)+(1.003)+(1.012), (I-746)+(1.003)+(1.013), (I-746)+(1.003)+(1.017), (I-746)+(1.003)+(1.018), (I-746)+(1.003)+(1.020), (I-746)+(1.003)+(1.021), (I-746)+(1.003)+(1.026), (I-746)+(1.003)+(1.027), (I-746)+(1.003)+(1.055), (I-746)+(1.003)+(1.059), (I-746)+(1.003)+(1.092), (I-746)+(1.003)+(2.001), (I-746)+(1.003)+(2.002), (I-746)+(1.003)+(2.003), (I-746)+(1.003)+(2.005), (I-746)+(1.003)+(2.007), (I-746)+(1.003)+(2.009), (I-746)+(1.003)+(2.010), (I-746)+(1.003)+(2.011), (I-746)+(1.003)+(2.012), (I-746)+(1.003)+(2.013), (I-746)+(1.003)+(2.014), (I-746)+(1.003)+(2.015), (I-746)+(1.003)+(2.016), (I-746)+(1.003)+(2.017), (I-746)+(1.003)+(2.018), (I-746)+(1.003)+(2.019), (I-746)+(1.003)+(2.021), (I-746)+(1.003)+(2.028), (I-746)+(1.003)+(2.030), (I-746)+(1.003)+(2.038), (I-746)+(1.003)+(3.003), (I-746)+(1.003)+(3.007), (I-746)+(1.003)+(3.012), (I-746)+(1.003)+(3.013), (I-746)+(1.003)+(3.016), (I-746)+(1.003)+(3.017), (I-746)+(1.003)+(3.020), (I-746)+(1.003)+(3.025), (I-746)+(1.003)+(3.026), (I-746)+(1.003)+(3.030), (I-746)+(1.003)+(3.031), (I-746)+(1.003)+(5.003), (I-746)+(1.003)+(5.004), (I-746)+(1.003)+(5.005), (I-746)+(1.003)+(5.008), (I-746)+(1.003)+(5.009), (I-746)+(1.003)+(5.011), (I-746)+(1.003)+(5.012), (I-746)+(1.003)+(5.013), (I-746)+(1.003)+(5.015), (I-746)+(1.003)+(5.018), (I-746)+(1.003)+(5.019), (I-746)+(1.003)+(6.002), (I-746)+(1.003)+(7.001), (I-746)+(1.003)+(7.005), (I-746)+(1.003)+(9.002), (I-746)+(1.003)+(9.004), (I-746)+(1.003)+(14.001), (I-746)+(1.003)+(14.002), (I-746)+(1.003)+(15.008), (I-746)+(1.003)+(15.011), (I-746)+(1.003)+(15.012), (I-746)+(1.003)+(15.016), (I-746)+(1.003)+(15.025), (I-746)+(1.003)+(15.027), (I-746)+(1.003)+(15.047), (I-746)+(1.003)+(15.063), (I-746)+(1.003)+(15.064), (I-746)+(1.003)+(16.001), (I-746)+(1.003)+(16.005), (I-746)+(1.003)+(17.001), (I-746)+(1.003)+(17.002), (I-746)+(1.003)+(17.003), (I-746)+(1.003)+(17.008), (I-746)+(1.003)+(18.001),

(I-746)+(1.004)+(1.001), (I-746)+(1.004)+(1.002), (I-746)+(1.004)+(1.003), (I-746)+(1.004)+(1.005), (I-746)+(1.004)+(1.006), (I-746)+(1.004)+(1.007), (I-746)+(1.004)+(1.010), (I-746)+(1.004)+(1.011), (I-746)+(1.004)+(1.012), (I-746)+(1.004)+(1.013), (I-746)+(1.004)+(1.017), (I-746)+(1.004)+(1.018), (I-746)+(1.004)+(1.020), (I-746)+(1.004)+(1.021), (I-746)+(1.004)+(1.026), (I-746)+(1.004)+(1.027), (I-746)+(1.004)+(1.055), (I-746)+(1.004)+(1.059), (I-746)+(1.004)+(1.092), (I-746)+(1.004)+(2.001), (I-746)+(1.004)+(2.002), (I-746)+(1.004)+(2.003), (I-746)+(1.004)+(2.005), (I-746)+(1.004)+(2.007), (I-746)+(1.004)+(2.009), (I-746)+(1.004)+(2.010), (I-746)+(1.004)+(2.011), (I-746)+(1.004)+(2.012), (I-746)+(1.004)+(2.013), (I-746)+(1.004)+(2.014), (I-746)+(1.004)+(2.015), (I-746)+(1.004)+(2.016), (I-746)+(1.004)+(2.017), (I-746)+(1.004)+(2.018), (I-746)+(1.004)+(2.019), (I-746)+(1.004)+(2.021), (I-746)+(1.004)+(2.028), (I-746)+(1.004)+(2.030), (I-746)+(1.004)+(2.038), (I-746)+(1.004)+(3.003), (I-746)+(1.004)+(3.007), (I-746)+(1.004)+(3.012), (I-746)+(1.004)+(3.013), (I-746)+(1.004)+(3.016), (I-746)+(1.004)+(3.017), (I-746)+(1.004)+(3.020), (I-746)+(1.004)+(3.025), (I-746)+(1.004)+(3.026), (I-746)+(1.004)+(3.030), (I-746)+(1.004)+(3.031), (I-746)+(1.004)+(5.003), (I-746)+(1.004)+(5.004), (I-746)+(1.004)+(5.005), (I-746)+(1.004)+(5.008), (I-746)+(1.004)+(5.009), (I-746)+(1.004)+(5.011), (I-746)+(1.004)+(5.012), (I-746)+(1.004)+(5.013), (I-746)+(1.004)+(5.015), (I-746)+(1.004)+(5.018), (I-746)+(1.004)+(5.019), (I-746)+(1.004)+(6.002), (I-746)+(1.004)+(7.001), (I-746)+(1.004)+(7.005), (I-746)+(1.004)+(9.002), (I-746)+(1.004)+(9.004), (I-746)+(1.004)+(14.001), (I-746)+(1.004)+(14.002), (I-746)+(1.004)+(15.008), (I-746)+(1.004)+(15.011), (I-746)+(1.004)+(15.012), (I-746)+(1.004)+(15.016), (I-746)+(1.004)+(15.025), (I-746)+(1.004)+(15.027), (I-746)+(1.004)+(15.047), (I-746)+(1.004)+(15.063), (I-746)+(1.004)+(15.064), (I-746)+(1.004)+(16.001), (I-746)+(1.004)+(16.005), (I-746)+(1.004)+(17.001), (I-746)+(1.004)+(17.002), (I-746)+(1.004)+(17.003), (I-746)+(1.004)+(17.008), (I-746)+(1.004)+(18.001),

(I-746)+(1.005)+(1.001), (I-746)+(1.005)+(1.002), (I-746)+(1.005)+(1.003), (I-746)+(1.005)+(1.004), (I-746)+(1.005)+(1.006), (I-746)+(1.005)+(1.007), (I-746)+(1.005)+(1.010), (I-746)+(1.005)+(1.011), (I-746)+(1.005)+(1.012), (I-746)+(1.005)+(1.013), (I-746)+(1.005)+(1.017), (I-746)+(1.005)+(1.018), (I-746)+(1.005)+(1.020), (I-746)+(1.005)+(1.021), (I-746)+(1.005)+(1.026), (I-746)+(1.005)+(1.027), (I-746)+(1.005)+(1.055), (I-746)+(1.005)+(1.059), (I-746)+(1.005)+(1.092), (I-746)+(1.005)+(2.001), (I-746)+(1.005)+(2.002), (I-746)+(1.005)+(2.003), (I-746)+(1.005)+(2.005), (I-746)+(1.005)+(2.007), (I-746)+(1.005)+(2.009), (I-746)+(1.005)+(2.010), (I-746)+(1.005)+(2.011), (I-746)+(1.005)+(2.012), (I-746)+(1.005)+(2.013), (I-746)+(1.005)+(2.014), (I-746)+(1.005)+(2.015), (I-746)+(1.005)+(2.016), (I-746)+(1.005)+(2.017), (I-746)+(1.005)+(2.018), (I-746)+(1.005)+(2.019), (I-746)+(1.005)+(2.021), (I-746)+(1.005)+(2.028), (I-746)+(1.005)+(2.030), (I-746)+(1.005)+(2.038), (I-746)+(1.005)+(3.003), (I-746)+(1.005)+(3.007), (I-746)+(1.005)+(3.012), (I-746)+(1.005)+(3.013), (I-746)+(1.005)+(3.016), (I-746)+(1.005)+(3.017), (I-746)+(1.005)+(3.020), (I-746)+(1.005)+(3.025), (I-746)+(1.005)+(3.026), (I-746)+(1.005)+(3.030), (I-746)+(1.005)+(3.031), (I-746)+(1.005)+(5.003), (I-746)+(1.005)+(5.004), (I-746)+(1.005)+(5.005), (I-746)+(1.005)+(5.008), (I-746)+(1.005)+(5.009), (I-746)+(1.005)+(5.011), (I-746)+(1.005)+(5.012), (I-746)+(1.005)+(5.013), (I-746)+(1.005)+(5.015), (I-746)+(1.005)+(5.018), (I-746)+(1.005)+(5.019), (I-746)+(1.005)+(6.002), (I-746)+(1.005)+(7.001), (I-746)+(1.005)+(7.005), (I-746)+(1.005)+(9.002), (I-746)+(1.005)+(9.004), (I-746)+(1.005)+(14.001), (I-746)+(1.005)+(14.002), (I-746)+(1.005)+(15.008), (I-746)+(1.005)+(15.011), (I-746)+(1.005)+(15.012), (I-746)+(1.005)+(15.016), (I-746)+(1.005)+(15.025), (I-746)+(1.005)+(15.027), (I-746)+(1.005)+(15.047), (I-746)+(1.005)+(15.063), (I-746)+(1.005)+(15.064), (I-746)+(1.005)+(16.001), (I-746)+(1.005)+(16.005), (I-746)+(1.005)+(17.001), (I-746)+(1.005)+(17.002), (I-746)+(1.005)+(17.003), (I-746)+(1.005)+(17.008), (I-746)+(1.005)+(18.001),

(I-746)+(1.006)+(1.001), (I-746)+(1.006)+(1.002), (I-746)+(1.006)+(1.003), (I-746)+(1.006)+(1.004), (I-746)+(1.006)+(1.005), (I-746)+(1.006)+(1.007), (I-746)+(1.006)+(1.010), (I-746)+(1.006)+(1.011), (I-746)+(1.006)+(1.012), (I-746)+(1.006)+(1.013), (I-746)+(1.006)+(1.017), (I-746)+(1.006)+(1.018), (I-746)+(1.006)+(1.020), (I-746)+(1.006)+(1.021), (I-746)+(1.006)+(1.026), (I-746)+(1.006)+(1.027), (I-746)+(1.006)+(1.055), (I-746)+(1.006)+(1.059), (I-746)+(1.006)+(1.092), (I-746)+(1.006)+(2.001), (I-746)+(1.006)+(2.002), (I-746)+(1.006)+(2.003), (I-746)+(1.006)+(2.005), (I-746)+(1.006)+(2.007), (I-746)+(1.006)+(2.009), (I-746)+(1.006)+(2.010), (I-746)+(1.006)+(2.011), (I-746)+(1.006)+(2.012), (I-746)+(1.006)+(2.013), (I-746)+(1.006)+(2.014), (I-746)+(1.006)+(2.015), (I-746)+(1.006)+(2.016), (I-746)+(1.006)+(2.017), (I-746)+(1.006)+(2.018), (I-746)+(1.006)+(2.019), (I-746)+(1.006)+(2.021), (I-746)+(1.006)+(2.028), (I-746)+(1.006)+(2.030), (I-746)+(1.006)+(2.038), (I-746)+(1.006)+(3.003), (I-746)+(1.006)+(3.007), (I-746)+(1.006)+(3.012), (I-746)+(1.006)+(3.013), (I-746)+(1.006)+(3.016), (I-746)+(1.006)+(3.017), (I-746)+(1.006)+(3.020), (I-746)+(1.006)+(3.025), (I-746)+(1.006)+(3.026), (I-746)+(1.006)+(3.030), (I-746)+(1.006)+(3.031), (I-746)+(1.006)+(5.003), (I-746)+(1.006)+(5.004), (I-746)+(1.006)+(5.005), (I-746)+(1.006)+(5.008), (I-746)+(1.006)+(5.009), (I-746)+(1.006)+(5.011), (I-746)+(1.006)+(5.012), (I-746)+(1.006)+(5.013), (I-746)+(1.006)+(5.015), (I-746)+(1.006)+(5.018), (I-746)+(1.006)+(5.019), (I-746)+(1.006)+(6.002), (I-746)+(1.006)+(7.001), (I-746)+(1.006)+(7.005), (I-746)+(1.006)+(9.002), (I-746)+(1.006)+(9.004), (I-746)+(1.006)+(14.001), (I-746)+(1.006)+(14.002), (I-746)+(1.006)+(15.008), (I-746)+(1.006)+(15.011), (I-746)+(1.006)+(15.012), (I-746)+(1.006)+(15.016), (I-746)+(1.006)+(15.025), (I-746)+(1.006)+(15.027), (I-746)+(1.006)+(15.047), (I-746)+(1.006)+(15.063), (I-746)+(1.006)+(15.064), (I-746)+(1.006)+(16.001), (I-746)+(1.006)+(16.005), (I-746)+(1.006)+(17.001), (I-746)+(1.006)+(17.002), (I-746)+(1.006)+(17.003), (I-746)+(1.006)+(17.008), (I-746)+(1.006)+(18.001),

(I-746)+(1.007)+(1.001), (I-746)+(1.007)+(1.002), (I-746)+(1.007)+(1.003), (I-746)+(1.007)+(1.004), (I-746)+(1.007)+(1.005), (I-746)+(1.007)+(1.006), (I-746)+(1.007)+(1.010), (I-746)+(1.007)+(1.011), (I-746)+(1.007)+(1.012), (I-746)+(1.007)+(1.013), (I-746)+(1.007)+(1.017), (I-746)+(1.007)+(1.018), (I-746)+(1.007)+(1.020), (I-746)+(1.007)+(1.021), (I-746)+(1.007)+(1.026), (I-746)+(1.007)+(1.027), (I-746)+(1.007)+(1.055), (I-746)+(1.007)+(1.059), (I-746)+(1.007)+(1.092), (I-746)+(1.007)+(2.001), (I-746)+(1.007)+(2.002), (I-746)+(1.007)+(2.003), (I-746)+(1.007)+(2.005), (I-746)+(1.007)+(2.007), (I-746)+(1.007)+(2.009), (I-746)+(1.007)+(2.010), (I-746)+(1.007)+(2.011), (I-746)+(1.007)+(2.012), (I-746)+(1.007)+(2.013), (I-746)+(1.007)+(2.014), (I-746)+(1.007)+(2.015), (I-746)+(1.007)+(2.016), (I-746)+(1.007)+(2.017), (I-746)+(1.007)+(2.018), (I-746)+(1.007)+(2.019), (I-746)+(1.007)+(2.021), (I-746)+(1.007)+(2.028), (I-746)+(1.007)+(2.030), (I-746)+(1.007)+(2.038), (I-746)+(1.007)+(3.003), (I-746)+(1.007)+(3.007), (I-746)+(1.007)+(3.012), (I-746)+(1.007)+(3.013), (I-746)+(1.007)+(3.016), (I-746)+(1.007)+(3.017), (I-746)+(1.007)+(3.020), (I-746)+(1.007)+(3.025), (I-746)+(1.007)+(3.026), (I-746)+(1.007)+(3.030), (I-746)+(1.007)+(3.031), (I-746)+(1.007)+(5.003), (I-746)+(1.007)+(5.004), (I-746)+(1.007)+(5.005), (I-746)+(1.007)+(5.008), (I-746)+(1.007)+(5.009), (I-746)+(1.007)+(5.011), (I-746)+(1.007)+(5.012), (I-746)+(1.007)+(5.013), (I-746)+(1.007)+(5.015), (I-746)+(1.007)+(5.018), (I-746)+(1.007)+(5.019), (I-746)+(1.007)+(6.002), (I-746)+(1.007)+(7.001), (I-746)+(1.007)+(7.005), (I-746)+(1.007)+(9.002), (I-746)+(1.007)+(9.004), (I-746)+(1.007)+(14.001), (I-746)+(1.007)+(14.002), (I-746)+(1.007)+(15.008), (I-746)+(1.007)+(15.011), (I-746)+(1.007)+(15.012), (I-746)+(1.007)+(15.016), (I-746)+(1.007)+(15.025), (I-746)+(1.007)+(15.027), (I-746)+(1.007)+(15.047), (I-746)+(1.007)+(15.063), (I-746)+(1.007)+(15.064), (I-746)+(1.007)+(16.001), (I-746)+(1.007)+(16.005), (I-746)+(1.007)+(17.001), (I-746)+(1.007)+(17.002), (I-746)+(1.007)+(17.003), (I-746)+(1.007)+(17.008), (I-746)+(1.007)+(18.001),

(I-746)+(1.010)+(1.001), (I-746)+(1.010)+(1.002), (I-746)+(1.010)+(1.003), (I-746)+(1.010)+(1.004), (I-746)+(1.010)+(1.005), (I-746)+(1.010)+(1.006), (I-746)+(1.010)+(1.007), (I-746)+(1.010)+(1.011), (I-746)+(1.010)+(1.012), (I-746)+(1.010)+(1.013), (I-746)+(1.010)+(1.017), (I-746)+(1.010)+(1.018), (I-746)+(1.010)+(1.020), (I-746)+(1.010)+(1.021), (I-746)+(1.010)+(1.026), (I-746)+(1.010)+(1.027), (I-746)+(1.010)+(1.055), (I-746)+(1.010)+(1.059), (I-746)+(1.010)+(1.092), (I-746)+(1.010)+(2.001), (I-746)+(1.010)+(2.002), (I-746)+(1.010)+(2.003), (I-746)+(1.010)+(2.005), (I-746)+(1.010)+(2.007), (I-746)+(1.010)+(2.009), (I-746)+(1.010)+(2.010), (I-746)+(1.010)+(2.011), (I-746)+(1.010)+(2.012), (I-746)+(1.010)+(2.013), (I-746)+(1.010)+(2.014), (I-746)+(1.010)+(2.015), (I-746)+(1.010)+(2.016), (I-746)+(1.010)+(2.017), (I-746)+(1.010)+(2.018), (I-746)+(1.010)+(2.019), (I-746)+(1.010)+(2.021), (I-746)+(1.010)+(2.028), (I-746)+(1.010)+(2.030), (I-746)+(1.010)+(2.038), (I-746)+(1.010)+(3.003), (I-746)+(1.010)+(3.007), (I-746)+(1.010)+(3.012), (I-746)+(1.010)+(3.013), (I-746)+(1.010)+(3.016), (I-746)+(1.010)+(3.017), (I-746)+(1.010)+(3.020), (I-746)+(1.010)+(3.025), (I-746)+(1.010)+(3.026), (I-746)+(1.010)+(3.030), (I-746)+(1.010)+(3.031), (I-746)+(1.010)+(5.003), (I-746)+(1.010)+(5.004), (I-746)+(1.010)+(5.005), (I-746)+(1.010)+(5.008), (I-746)+(1.010)+(5.009), (I-746)+(1.010)+(5.011), (I-746)+(1.010)+(5.012), (I-746)+(1.010)+(5.013), (I-746)+(1.010)+(5.015), (I-746)+(1.010)+(5.018), (I-746)+(1.010)+(5.019), (I-746)+(1.010)+(6.002), (I-746)+(1.010)+(7.001), (I-746)+(1.010)+(7.005), (I-746)+(1.010)+(9.002), (I-746)+(1.010)+(9.004), (I-746)+(1.010)+(14.001), (I-746)+(1.010)+(14.002), (I-746)+(1.010)+(15.008), (I-746)+(1.010)+(15.011), (I-746)+(1.010)+(15.012), (I-746)+(1.010)+(15.016), (I-746)+(1.010)+(15.025), (I-746)+(1.010)+(15.027), (I-746)+(1.010)+(15.047), (I-746)+(1.010)+(15.063), (I-746)+(1.010)+(15.064), (I-746)+(1.010)+(16.001), (I-746)+(1.010)+(16.005), (I-746)+(1.010)+(17.001), (I-746)+(1.010)+(17.002), (I-746)+(1.010)+(17.003), (I-746)+(1.010)+(17.008), (I-746)+(1.010)+(18.001),

(I-746)+(1.011)+(1.001), (I-746)+(1.011)+(1.002), (I-746)+(1.011)+(1.003), (I-746)+(1.011)+(1.004), (I-746)+(1.011)+(1.005), (I-746)+(1.011)+(1.006), (I-746)+(1.011)+(1.007), (I-746)+(1.011)+(1.010), (I-746)+(1.011)+(1.012), (I-746)+(1.011)+(1.013), (I-746)+(1.011)+(1.017), (I-746)+(1.011)+(1.018), (I-746)+(1.011)+(1.020), (I-746)+(1.011)+(1.021), (I-746)+(1.011)+(1.026), (I-746)+(1.011)+(1.027), (I-746)+(1.011)+(1.055), (I-746)+(1.011)+(1.059), (I-746)+(1.011)+(1.092), (I-746)+(1.011)+(2.001), (I-746)+(1.011)+(2.002), (I-746)+(1.011)+(2.003), (I-746)+(1.011)+(2.005), (I-746)+(1.011)+(2.007), (I-746)+(1.011)+(2.009), (I-746)+(1.011)+(2.010), (I-746)+(1.011)+(2.011), (I-746)+(1.011)+(2.012), (I-746)+(1.011)+(2.013), (I-746)+(1.011)+(2.014), (I-746)+(1.011)+(2.015), (I-746)+(1.011)+(2.016), (I-746)+(1.011)+(2.017), (I-746)+(1.011)+(2.018), (I-746)+(1.011)+(2.019), (I-746)+(1.011)+(2.021), (I-746)+(1.011)+(2.028), (I-746)+(1.011)+(2.030), (I-746)+(1.011)+(2.038), (I-746)+(1.011)+(3.003), (I-746)+(1.011)+(3.007), (I-746)+(1.011)+(3.012), (I-746)+(1.011)+(3.013), (I-746)+(1.011)+(3.016), (I-746)+(1.011)+(3.017), (I-746)+(1.011)+(3.020), (I-746)+(1.011)+(3.025), (I-746)+(1.011)+(3.026), (I-746)+(1.011)+(3.030), (I-746)+(1.011)+(3.031), (I-746)+(1.011)+(5.003), (I-746)+(1.011)+(5.004), (I-746)+(1.011)+(5.005), (I-746)+(1.011)+(5.008), (I-746)+(1.011)+(5.009), (I-746)+(1.011)+(5.011), (I-746)+(1.011)+(5.012), (I-746)+(1.011)+(5.013), (I-746)+(1.011)+(5.015), (I-746)+(1.011)+(5.018), (I-746)+(1.011)+(5.019), (I-746)+(1.011)+(6.002), (I-746)+(1.011)+(7.001), (I-746)+(1.011)+(7.005), (I-746)+(1.011)+(9.002), (I-746)+(1.011)+(9.004), (I-746)+(1.011)+(14.001), (I-746)+(1.011)+(14.002), (I-746)+(1.011)+(15.008), (I-746)+(1.011)+(15.011), (I-746)+(1.011)+(15.012), (I-746)+(1.011)+(15.016), (I-746)+(1.011)+(15.025), (I-746)+(1.011)+(15.027), (I-746)+(1.011)+(15.047), (I-746)+(1.011)+(15.063), (I-746)+(1.011)+(15.064), (I-746)+(1.011)+(16.001), (I-746)+(1.011)+(16.005), (I-746)+(1.011)+(17.001), (I-746)+(1.011)+(17.002), (I-746)+(1.011)+(17.003), (I-746)+(1.011)+(17.008), (I-746)+(1.011)+(18.001),

(I-746)+(1.012)+(1.001), (I-746)+(1.012)+(1.002), (I-746)+(1.012)+(1.003), (I-746)+(1.012)+(1.004), (I-746)+(1.012)+(1.005), (I-746)+(1.012)+(1.006), (I-746)+(1.012)+(1.007), (I-746)+(1.012)+(1.010), (I-746)+(1.012)+(1.011), (I-746)+(1.012)+(1.013), (I-746)+(1.012)+(1.017), (I-746)+(1.012)+(1.018), (I-746)+(1.012)+(1.020), (I-746)+(1.012)+(1.021), (I-746)+(1.012)+(1.026), (I-746)+(1.012)+(1.027), (I-746)+(1.012)+(1.055), (I-746)+(1.012)+(1.059), (I-746)+(1.012)+(1.092), (I-746)+(1.012)+(2.001), (I-746)+(1.012)+(2.002), (I-746)+(1.012)+(2.003), (I-746)+(1.012)+(2.005), (I-746)+(1.012)+(2.007), (I-746)+(1.012)+(2.009), (I-746)+(1.012)+(2.010), (I-746)+(1.012)+(2.011), (I-746)+(1.012)+(2.012), (I-746)+(1.012)+(2.013), (I-746)+(1.012)+(2.014), (I-746)+(1.012)+(2.015), (I-746)+(1.012)+(2.016), (I-746)+(1.012)+(2.017), (I-746)+(1.012)+(2.018), (I-746)+(1.012)+(2.019), (I-746)+(1.012)+(2.021), (I-746)+(1.012)+(2.028), (I-746)+(1.012)+(2.030), (I-746)+(1.012)+(2.038), (I-746)+(1.012)+(3.003), (I-746)+(1.012)+(3.007), (I-746)+(1.012)+(3.012), (I-746)+(1.012)+(3.013), (I-746)+(1.012)+(3.016), (I-746)+(1.012)+(3.017), (I-746)+(1.012)+(3.020), (I-746)+(1.012)+(3.025), (I-746)+(1.012)+(3.026), (I-746)+(1.012)+(3.030), (I-746)+(1.012)+(3.031), (I-746)+(1.012)+(5.003), (I-746)+(1.012)+(5.004), (I-746)+(1.012)+(5.005), (I-746)+(1.012)+(5.008), (I-746)+(1.012)+(5.009), (I-746)+(1.012)+(5.011), (I-746)+(1.012)+(5.012), (I-746)+(1.012)+(5.013), (I-746)+(1.012)+(5.015), (I-746)+(1.012)+(5.018), (I-746)+(1.012)+(5.019), (I-746)+(1.012)+(6.002), (I-746)+(1.012)+(7.001), (I-746)+(1.012)+(7.005), (I-746)+(1.012)+(9.002), (I-746)+(1.012)+(9.004), (I-746)+(1.012)+(14.001), (I-746)+(1.012)+(14.002), (I-746)+(1.012)+(15.008), (I-746)+(1.012)+(15.011), (I-746)+(1.012)+(15.012), (I-746)+(1.012)+(15.016), (I-746)+(1.012)+(15.025), (I-746)+(1.012)+(15.027), (I-746)+(1.012)+(15.047), (I-746)+(1.012)+(15.063), (I-746)+(1.012)+(15.064), (I-746)+(1.012)+(16.001), (I-746)+(1.012)+(16.005), (I-746)+(1.012)+(17.001), (I-746)+(1.012)+(17.002), (I-746)+(1.012)+(17.003), (I-746)+(1.012)+(17.008), (I-746)+(1.012)+(18.001),

(I-746)+(1.013)+(1.001), (I-746)+(1.013)+(1.002), (I-746)+(1.013)+(1.003), (I-746)+(1.013)+(1.004), (I-746)+(1.013)+(1.005), (I-746)+(1.013)+(1.006), (I-746)+(1.013)+(1.007), (I-746)+(1.013)+(1.010), (I-746)+(1.013)+(1.011), (I-746)+(1.013)+(1.012), (I-746)+(1.013)+(1.017), (I-746)+(1.013)+(1.018), (I-746)+(1.013)+(1.020), (I-746)+(1.013)+(1.021), (I-746)+(1.013)+(1.026), (I-746)+(1.013)+(1.027), (I-746)+(1.013)+(1.055), (I-746)+(1.013)+(1.059), (I-746)+(1.013)+(1.092), (I-746)+(1.013)+(2.001), (I-746)+(1.013)+(2.002), (I-746)+(1.013)+(2.003), (I-746)+(1.013)+(2.005), (I-746)+(1.013)+(2.007), (I-746)+(1.013)+(2.009), (I-746)+(1.013)+(2.010), (I-746)+(1.013)+(2.011), (I-746)+(1.013)+(2.012), (I-746)+(1.013)+(2.013), (I-746)+(1.013)+(2.014), (I-746)+(1.013)+(2.015), (I-746)+(1.013)+(2.016), (I-746)+(1.013)+(2.017), (I-746)+(1.013)+(2.018), (I-746)+(1.013)+(2.019), (I-746)+(1.013)+(2.021), (I-746)+(1.013)+(2.028), (I-746)+(1.013)+(2.030), (I-746)+(1.013)+(2.038), (I-746)+(1.013)+(3.003), (I-746)+(1.013)+(3.007), (I-746)+(1.013)+(3.012), (I-746)+(1.013)+(3.013), (I-746)+(1.013)+(3.016), (I-746)+(1.013)+(3.017), (I-746)+(1.013)+(3.020), (I-746)+(1.013)+(3.025), (I-746)+(1.013)+(3.026), (I-746)+(1.013)+(3.030), (I-746)+(1.013)+(3.031), (I-746)+(1.013)+(5.003), (I-746)+(1.013)+(5.004), (I-746)+(1.013)+(5.005), (I-746)+(1.013)+(5.008), (I-746)+(1.013)+(5.009), (I-746)+(1.013)+(5.011), (I-746)+(1.013)+(5.012), (I-746)+(1.013)+(5.013), (I-746)+(1.013)+(5.015), (I-746)+(1.013)+(5.018), (I-746)+(1.013)+(5.019), (I-746)+(1.013)+(6.002), (I-746)+(1.013)+(7.001), (I-746)+(1.013)+(7.005), (I-746)+(1.013)+(9.002), (I-746)+(1.013)+(9.004), (I-746)+(1.013)+(14.001), (I-746)+(1.013)+(14.002), (I-746)+(1.013)+(15.008), (I-746)+(1.013)+(15.011), (I-746)+(1.013)+(15.012), (I-746)+(1.013)+(15.016), (I-746)+(1.013)+(15.025), (I-746)+(1.013)+(15.027), (I-746)+(1.013)+(15.047), (I-746)+(1.013)+(15.063), (I-746)+(1.013)+(15.064), (I-746)+(1.013)+(16.001), (I-746)+(1.013)+(16.005), (I-746)+(1.013)+(17.001), (I-746)+(1.013)+(17.002), (I-746)+(1.013)+(17.003), (I-746)+(1.013)+(17.008), (I-746)+(1.013)+(18.001),

(I-746)+(1.017)+(1.001), (I-746)+(1.017)+(1.002), (I-746)+(1.017)+(1.003), (I-746)+(1.017)+(1.004), (I-746)+(1.017)+(1.005), (I-746)+(1.017)+(1.006), (I-746)+(1.017)+(1.007), (I-746)+(1.017)+(1.010), (I-746)+(1.017)+(1.011), (I-746)+(1.017)+(1.012), (I-746)+(1.017)+(1.013), (I-746)+(1.017)+(1.018), (I-746)+(1.017)+(1.020), (I-746)+(1.017)+(1.021), (I-746)+(1.017)+(1.026), (I-746)+(1.017)+(1.027), (I-746)+(1.017)+(1.055), (I-746)+(1.017)+(1.059), (I-746)+(1.017)+(1.092), (I-746)+(1.017)+(2.001), (I-746)+(1.017)+(2.002), (I-746)+(1.017)+(2.003), (I-746)+(1.017)+(2.005), (I-746)+(1.017)+(2.007), (I-746)+(1.017)+(2.009), (I-746)+(1.017)+(2.010), (I-746)+(1.017)+(2.011), (I-746)+(1.017)+(2.012), (I-746)+(1.017)+(2.013), (I-746)+(1.017)+(2.014), (I-746)+(1.017)+(2.015), (I-746)+(1.017)+(2.016), (I-746)+(1.017)+(2.017), (I-746)+(1.017)+(2.018), (I-746)+(1.017)+(2.019), (I-746)+(1.017)+(2.021), (I-746)+(1.017)+(2.028), (I-746)+(1.017)+(2.030), (I-746)+(1.017)+(2.038), (I-746)+(1.017)+(3.003), (I-746)+(1.017)+(3.007), (I-746)+(1.017)+(3.012), (I-746)+(1.017)+(3.013), (I-746)+(1.017)+(3.016), (I-746)+(1.017)+(3.017), (I-746)+(1.017)+(3.020), (I-746)+(1.017)+(3.025), (I-746)+(1.017)+(3.026), (I-746)+(1.017)+(3.030), (I-746)+(1.017)+(3.031), (I-746)+(1.017)+(5.003), (I-746)+(1.017)+(5.004), (I-746)+(1.017)+(5.005), (I-746)+(1.017)+(5.008), (I-746)+(1.017)+(5.009), (I-746)+(1.017)+(5.011), (I-746)+(1.017)+(5.012), (I-746)+(1.017)+(5.013), (I-746)+(1.017)+(5.015), (I-746)+(1.017)+(5.018), (I-746)+(1.017)+(5.019), (I-746)+(1.017)+(6.002), (I-746)+(1.017)+(7.001), (I-746)+(1.017)+(7.005), (I-746)+(1.017)+(9.002), (I-746)+(1.017)+(9.004), (I-746)+(1.017)+(14.001), (I-746)+(1.017)+(14.002), (I-746)+(1.017)+(15.008), (I-746)+(1.017)+(15.011), (I-746)+(1.017)+(15.012), (I-746)+(1.017)+(15.016), (I-746)+(1.017)+(15.025), (I-746)+(1.017)+(15.027), (I-746)+(1.017)+(15.047), (I-746)+(1.017)+(15.063), (I-746)+(1.017)+(15.064), (I-746)+(1.017)+(16.001), (I-746)+(1.017)+(16.005), (I-746)+(1.017)+(17.001), (I-746)+(1.017)+(17.002), (I-746)+(1.017)+(17.003), (I-746)+(1.017)+(17.008), (I-746)+(1.017)+(18.001),

(I-746)+(1.018)+(1.001), (I-746)+(1.018)+(1.002), (I-746)+(1.018)+(1.003), (I-746)+(1.018)+(1.004), (I-746)+(1.018)+(1.005), (I-746)+(1.018)+(1.006), (I-746)+(1.018)+(1.007), (I-746)+(1.018)+(1.010), (I-746)+(1.018)+(1.011), (I-746)+(1.018)+(1.012), (I-746)+(1.018)+(1.013), (I-746)+(1.018)+(1.017), (I-746)+(1.018)+(1.020), (I-746)+(1.018)+(1.021), (I-746)+(1.018)+(1.026), (I-746)+(1.018)+(1.027), (I-746)+(1.018)+(1.055), (I-746)+(1.018)+(1.059), (I-746)+(1.018)+(1.092), (I-746)+(1.018)+(2.001), (I-746)+(1.018)+(2.002), (I-746)+(1.018)+(2.003), (I-746)+(1.018)+(2.005), (I-746)+(1.018)+(2.007), (I-746)+(1.018)+(2.009), (I-746)+(1.018)+(2.010), (I-746)+(1.018)+(2.011), (I-746)+(1.018)+(2.012), (I-746)+(1.018)+(2.013), (I-746)+(1.018)+(2.014), (I-746)+(1.018)+(2.015), (I-746)+(1.018)+(2.016), (I-746)+(1.018)+(2.017), (I-746)+(1.018)+(2.018), (I-746)+(1.018)+(2.019), (I-746)+(1.018)+(2.021), (I-746)+(1.018)+(2.028), (I-746)+(1.018)+(2.030), (I-746)+(1.018)+(2.038), (I-746)+(1.018)+(3.003), (I-746)+(1.018)+(3.007), (I-746)+(1.018)+(3.012), (I-746)+(1.018)+(3.013), (I-746)+(1.018)+(3.016), (I-746)+(1.018)+(3.017), (I-746)+(1.018)+(3.020), (I-746)+(1.018)+(3.025), (I-746)+(1.018)+(3.026), (I-746)+(1.018)+(3.030), (I-746)+(1.018)+(3.031), (I-746)+(1.018)+(5.003), (I-746)+(1.018)+(5.004), (I-746)+(1.018)+(5.005), (I-746)+(1.018)+(5.008), (I-746)+(1.018)+(5.009), (I-746)+(1.018)+(5.011), (I-746)+(1.018)+(5.012), (I-746)+(1.018)+(5.013), (I-746)+(1.018)+(5.015), (I-746)+(1.018)+(5.018), (I-746)+(1.018)+(5.019), (I-746)+(1.018)+(6.002), (I-746)+(1.018)+(7.001), (I-746)+(1.018)+(7.005), (I-746)+(1.018)+(9.002), (I-746)+(1.018)+(9.004), (I-746)+(1.018)+(14.001), (I-746)+(1.018)+(14.002), (I-746)+(1.018)+(15.008), (I-746)+(1.018)+(15.011), (I-746)+(1.018)+(15.012), (I-746)+(1.018)+(15.016), (I-746)+(1.018)+(15.025), (I-746)+(1.018)+(15.027), (I-746)+(1.018)+(15.047), (I-746)+(1.018)+(15.063), (I-746)+(1.018)+(15.064), (I-746)+(1.018)+(16.001), (I-746)+(1.018)+(16.005), (I-746)+(1.018)+(17.001), (I-746)+(1.018)+(17.002), (I-746)+(1.018)+(17.003), (I-746)+(1.018)+(17.008), (I-746)+(1.018)+(18.001),

(I-746)+(1.020)+(1.001), (I-746)+(1.020)+(1.002), (I-746)+(1.020)+(1.003), (I-746)+(1.020)+(1.004), (I-746)+(1.020)+(1.005), (I-746)+(1.020)+(1.006), (I-746)+(1.020)+(1.007), (I-746)+(1.020)+(1.010), (I-746)+(1.020)+(1.011), (I-746)+(1.020)+(1.012), (I-746)+(1.020)+(1.013), (I-746)+(1.020)+(1.017), (I-746)+(1.020)+(1.018), (I-746)+(1.020)+(1.021), (I-746)+(1.020)+(1.026), (I-746)+(1.020)+(1.027), (I-746)+(1.020)+(1.055), (I-746)+(1.020)+(1.059), (I-746)+(1.020)+(1.092), (I-746)+(1.020)+(2.001), (I-746)+(1.020)+(2.002), (I-746)+(1.020)+(2.003), (I-746)+(1.020)+(2.005), (I-746)+(1.020)+(2.007), (I-746)+(1.020)+(2.009), (I-746)+(1.020)+(2.010), (I-746)+(1.020)+(2.011), (I-746)+(1.020)+(2.012), (I-746)+(1.020)+(2.013), (I-746)+(1.020)+(2.014), (I-746)+(1.020)+(2.015), (I-746)+(1.020)+(2.016), (I-746)+(1.020)+(2.017), (I-746)+(1.020)+(2.018), (I-746)+(1.020)+(2.019), (I-746)+(1.020)+(2.021), (I-746)+(1.020)+(2.028), (I-746)+(1.020)+(2.030), (I-746)+(1.020)+(2.038), (I-746)+(1.020)+(3.003), (I-746)+(1.020)+(3.007), (I-746)+(1.020)+(3.012), (I-746)+(1.020)+(3.013), (I-746)+(1.020)+(3.016), (I-746)+(1.020)+(3.017), (I-746)+(1.020)+(3.020), (I-746)+(1.020)+(3.025), (I-746)+(1.020)+(3.026), (I-746)+(1.020)+(3.030), (I-746)+(1.020)+(3.031), (I-746)+(1.020)+(5.003), (I-746)+(1.020)+(5.004), (I-746)+(1.020)+(5.005), (I-746)+(1.020)+(5.008), (I-746)+(1.020)+(5.009), (I-746)+(1.020)+(5.011), (I-746)+(1.020)+(5.012), (I-746)+(1.020)+(5.013), (I-746)+(1.020)+(5.015), (I-746)+(1.020)+(5.018), (I-746)+(1.020)+(5.019), (I-746)+(1.020)+(6.002), (I-746)+(1.020)+(7.001), (I-746)+(1.020)+(7.005), (I-746)+(1.020)+(9.002), (I-746)+(1.020)+(9.004), (I-746)+(1.020)+(14.001), (I-746)+(1.020)+(14.002), (I-746)+(1.020)+(15.008), (I-746)+(1.020)+(15.011), (I-746)+(1.020)+(15.012), (I-746)+(1.020)+(15.016), (I-746)+(1.020)+(15.025), (I-746)+(1.020)+(15.027), (I-746)+(1.020)+(15.047), (I-746)+(1.020)+(15.063), (I-746)+(1.020)+(15.064), (I-746)+(1.020)+(16.001), (I-746)+(1.020)+(16.005), (I-746)+(1.020)+(17.001), (I-746)+(1.020)+(17.002), (I-746)+(1.020)+(17.003), (I-746)+(1.020)+(17.008), (I-746)+(1.020)+(18.001),

(I-746)+(1.021)+(1.001), (I-746)+(1.021)+(1.002), (I-746)+(1.021)+(1.003), (I-746)+(1.021)+(1.004), (I-746)+(1.021)+(1.005), (I-746)+(1.021)+(1.006), (I-746)+(1.021)+(1.007), (I-746)+(1.021)+(1.010), (I-746)+(1.021)+(1.011), (I-746)+(1.021)+(1.012), (I-746)+(1.021)+(1.013), (I-746)+(1.021)+(1.017), (I-746)+(1.021)+(1.018), (I-746)+(1.021)+(1.020), (I-746)+(1.021)+(1.026), (I-746)+(1.021)+(1.027), (I-746)+(1.021)+(1.055), (I-746)+(1.021)+(1.059), (I-746)+(1.021)+(1.092), (I-746)+(1.021)+(2.001), (I-746)+(1.021)+(2.002), (I-746)+(1.021)+(2.003), (I-746)+(1.021)+(2.005), (I-746)+(1.021)+(2.007), (I-746)+(1.021)+(2.009), (I-746)+(1.021)+(2.010), (I-746)+(1.021)+(2.011), (I-746)+(1.021)+(2.012), (I-746)+(1.021)+(2.013), (I-746)+(1.021)+(2.014), (I-746)+(1.021)+(2.015), (I-746)+(1.021)+(2.016), (I-746)+(1.021)+(2.017), (I-746)+(1.021)+(2.018), (I-746)+(1.021)+(2.019), (I-746)+(1.021)+(2.021), (I-746)+(1.021)+(2.028), (I-746)+(1.021)+(2.030), (I-746)+(1.021)+(2.038), (I-746)+(1.021)+(3.003), (I-746)+(1.021)+(3.007), (I-746)+(1.021)+(3.012), (I-746)+(1.021)+(3.013), (I-746)+(1.021)+(3.016), (I-746)+(1.021)+(3.017), (I-746)+(1.021)+(3.020), (I-746)+(1.021)+(3.025), (I-746)+(1.021)+(3.026), (I-746)+(1.021)+(3.030), (I-746)+(1.021)+(3.031), (I-746)+(1.021)+(5.003), (I-746)+(1.021)+(5.004), (I-746)+(1.021)+(5.005), (I-746)+(1.021)+(5.008), (I-746)+(1.021)+(5.009), (I-746)+(1.021)+(5.011), (I-746)+(1.021)+(5.012), (I-746)+(1.021)+(5.013), (I-746)+(1.021)+(5.015), (I-746)+(1.021)+(5.018), (I-746)+(1.021)+(5.019), (I-746)+(1.021)+(6.002), (I-746)+(1.021)+(7.001), (I-746)+(1.021)+(7.005), (I-746)+(1.021)+(9.002), (I-746)+(1.021)+(9.004), (I-746)+(1.021)+(14.001), (I-746)+(1.021)+(14.002), (I-746)+(1.021)+(15.008), (I-746)+(1.021)+(15.011), (I-746)+(1.021)+(15.012), (I-746)+(1.021)+(15.016), (I-746)+(1.021)+(15.025), (I-746)+(1.021)+(15.027), (I-746)+(1.021)+(15.047), (I-746)+(1.021)+(15.063), (I-746)+(1.021)+(15.064), (I-746)+(1.021)+(16.001), (I-746)+(1.021)+(16.005), (I-746)+(1.021)+(17.001), (I-746)+(1.021)+(17.002), (I-746)+(1.021)+(17.003), (I-746)+(1.021)+(17.008), (I-746)+(1.021)+(18.001),

(I-746)+(1.026)+(1.001), (I-746)+(1.026)+(1.002), (I-746)+(1.026)+(1.003), (I-746)+(1.026)+(1.004), (I-746)+(1.026)+(1.005), (I-746)+(1.026)+(1.006), (I-746)+(1.026)+(1.007), (I-746)+(1.026)+(1.010), (I-746)+(1.026)+(1.011), (I-746)+(1.026)+(1.012), (I-746)+(1.026)+(1.013), (I-746)+(1.026)+(1.017), (I-746)+(1.026)+(1.018), (I-746)+(1.026)+(1.020), (I-746)+(1.026)+(1.021), (I-746)+(1.026)+(1.027), (I-746)+(1.026)+(1.055), (I-746)+(1.026)+(1.059), (I-746)+(1.026)+(1.092), (I-746)+(1.026)+(2.001), (I-746)+(1.026)+(2.002), (I-746)+(1.026)+(2.003), (I-746)+(1.026)+(2.005), (I-746)+(1.026)+(2.007), (I-746)+(1.026)+(2.009), (I-746)+(1.026)+(2.010), (I-746)+(1.026)+(2.011), (I-746)+(1.026)+(2.012), (I-746)+(1.026)+(2.013), (I-746)+(1.026)+(2.014), (I-746)+(1.026)+(2.015), (I-746)+(1.026)+(2.016), (I-746)+(1.026)+(2.017), (I-746)+(1.026)+(2.018), (I-746)+(1.026)+(2.019), (I-746)+(1.026)+(2.021), (I-746)+(1.026)+(2.028), (I-746)+(1.026)+(2.030), (I-746)+(1.026)+(2.038), (I-746)+(1.026)+(3.003), (I-746)+(1.026)+(3.007), (I-746)+(1.026)+(3.012), (I-746)+(1.026)+(3.013), (I-746)+(1.026)+(3.016), (I-746)+(1.026)+(3.017), (I-746)+(1.026)+(3.020), (I-746)+(1.026)+(3.025), (I-746)+(1.026)+(3.026), (I-746)+(1.026)+(3.030), (I-746)+(1.026)+(3.031), (I-746)+(1.026)+(5.003), (I-746)+(1.026)+(5.004), (I-746)+(1.026)+(5.005), (I-746)+(1.026)+(5.008), (I-746)+(1.026)+(5.009), (I-746)+(1.026)+(5.011), (I-746)+(1.026)+(5.012), (I-746)+(1.026)+(5.013), (I-746)+(1.026)+(5.015), (I-746)+(1.026)+(5.018), (I-746)+(1.026)+(5.019), (I-746)+(1.026)+(6.002), (I-746)+(1.026)+(7.001), (I-746)+(1.026)+(7.005), (I-746)+(1.026)+(9.002), (I-746)+(1.026)+(9.004), (I-746)+(1.026)+(14.001), (I-746)+(1.026)+(14.002), (I-746)+(1.026)+(15.008), (I-746)+(1.026)+(15.011), (I-746)+(1.026)+(15.012), (I-746)+(1.026)+(15.016), (I-746)+(1.026)+(15.025), (I-746)+(1.026)+(15.027), (I-746)+(1.026)+(15.047), (I-746)+(1.026)+(15.063), (I-746)+(1.026)+(15.064), (I-746)+(1.026)+(16.001), (I-746)+(1.026)+(16.005), (I-746)+(1.026)+(17.001), (I-746)+(1.026)+(17.002), (I-746)+(1.026)+(17.003), (I-746)+(1.026)+(17.008), (I-746)+(1.026)+(18.001),

(I-746)+(1.027)+(1.001), (I-746)+(1.027)+(1.002), (I-746)+(1.027)+(1.003), (I-746)+(1.027)+(1.004), (I-746)+(1.027)+(1.005), (I-746)+(1.027)+(1.006), (I-746)+(1.027)+(1.007), (I-746)+(1.027)+(1.010), (I-746)+(1.027)+(1.011), (I-746)+(1.027)+(1.012), (I-746)+(1.027)+(1.013), (I-746)+(1.027)+(1.017), (I-746)+(1.027)+(1.018), (I-746)+(1.027)+(1.020), (I-746)+(1.027)+(1.021), (I-746)+(1.027)+(1.026), (I-746)+(1.027)+(1.055), (I-746)+(1.027)+(1.059), (I-746)+(1.027)+(1.092), (I-746)+(1.027)+(2.001), (I-746)+(1.027)+(2.002), (I-746)+(1.027)+(2.003), (I-746)+(1.027)+(2.005), (I-746)+(1.027)+(2.007), (I-746)+(1.027)+(2.009), (I-746)+(1.027)+(2.010), (I-746)+(1.027)+(2.011), (I-746)+(1.027)+(2.012), (I-746)+(1.027)+(2.013), (I-746)+(1.027)+(2.014), (I-746)+(1.027)+(2.015), (I-746)+(1.027)+(2.016), (I-746)+(1.027)+(2.017), (I-746)+(1.027)+(2.018), (I-746)+(1.027)+(2.019), (I-746)+(1.027)+(2.021), (I-746)+(1.027)+(2.028), (I-746)+(1.027)+(2.030), (I-746)+(1.027)+(2.038), (I-746)+(1.027)+(3.003), (I-746)+(1.027)+(3.007), (I-746)+(1.027)+(3.012), (I-746)+(1.027)+(3.013), (I-746)+(1.027)+(3.016), (I-746)+(1.027)+(3.017), (I-746)+(1.027)+(3.020), (I-746)+(1.027)+(3.025), (I-746)+(1.027)+(3.026), (I-746)+(1.027)+(3.030), (I-746)+(1.027)+(3.031), (I-746)+(1.027)+(5.003), (I-746)+(1.027)+(5.004), (I-746)+(1.027)+(5.005), (I-746)+(1.027)+(5.008), (I-746)+(1.027)+(5.009), (I-746)+(1.027)+(5.011), (I-746)+(1.027)+(5.012), (I-746)+(1.027)+(5.013), (I-746)+(1.027)+(5.015), (I-746)+(1.027)+(5.018), (I-746)+(1.027)+(5.019), (I-746)+(1.027)+(6.002), (I-746)+(1.027)+(7.001), (I-746)+(1.027)+(7.005), (I-746)+(1.027)+(9.002), (I-746)+(1.027)+(9.004), (I-746)+(1.027)+(14.001), (I-746)+(1.027)+(14.002), (I-746)+(1.027)+(15.008), (I-746)+(1.027)+(15.011), (I-746)+(1.027)+(15.012), (I-746)+(1.027)+(15.016), (I-746)+(1.027)+(15.025), (I-746)+(1.027)+(15.027), (I-746)+(1.027)+(15.047), (I-746)+(1.027)+(15.063), (I-746)+(1.027)+(15.064), (I-746)+(1.027)+(16.001), (I-746)+(1.027)+(16.005), (I-746)+(1.027)+(17.001), (I-746)+(1.027)+(17.002), (I-746)+(1.027)+(17.003), (I-746)+(1.027)+(17.008), (I-746)+(1.027)+(18.001),

(I-746)+(1.055)+(1.001), (I-746)+(1.055)+(1.002), (I-746)+(1.055)+(1.003), (I-746)+(1.055)+(1.004), (I-746)+(1.055)+(1.005), (I-746)+(1.055)+(1.006), (I-746)+(1.055)+(1.007), (I-746)+(1.055)+(1.010), (I-746)+(1.055)+(1.011), (I-746)+(1.055)+(1.012), (I-746)+(1.055)+(1.013), (I-746)+(1.055)+(1.017), (I-746)+(1.055)+(1.018), (I-746)+(1.055)+(1.020), (I-746)+(1.055)+(1.021), (I-746)+(1.055)+(1.026), (I-746)+(1.055)+(1.027), (I-746)+(1.055)+(1.059), (I-746)+(1.055)+(1.092), (I-746)+(1.055)+(2.001), (I-746)+(1.055)+(2.002), (I-746)+(1.055)+(2.003), (I-746)+(1.055)+(2.005), (I-746)+(1.055)+(2.007), (I-746)+(1.055)+(2.009), (I-746)+(1.055)+(2.010), (I-746)+(1.055)+(2.011), (I-746)+(1.055)+(2.012), (I-746)+(1.055)+(2.013), (I-746)+(1.055)+(2.014), (I-746)+(1.055)+(2.015), (I-746)+(1.055)+(2.016), (I-746)+(1.055)+(2.017), (I-746)+(1.055)+(2.018), (I-746)+(1.055)+(2.019), (I-746)+(1.055)+(2.021), (I-746)+(1.055)+(2.028), (I-746)+(1.055)+(2.030), (I-746)+(1.055)+(2.038), (I-746)+(1.055)+(3.003), (I-746)+(1.055)+(3.007), (I-746)+(1.055)+(3.012), (I-746)+(1.055)+(3.013), (I-746)+(1.055)+(3.016), (I-746)+(1.055)+(3.017), (I-746)+(1.055)+(3.020), (I-746)+(1.055)+(3.025), (I-746)+(1.055)+(3.026), (I-746)+(1.055)+(3.030), (I-746)+(1.055)+(3.031), (I-746)+(1.055)+(5.003), (I-746)+(1.055)+(5.004), (I-746)+(1.055)+(5.005), (I-746)+(1.055)+(5.008), (I-746)+(1.055)+(5.009), (I-746)+(1.055)+(5.011), (I-746)+(1.055)+(5.012), (I-746)+(1.055)+(5.013), (I-746)+(1.055)+(5.015), (I-746)+(1.055)+(5.018), (I-746)+(1.055)+(5.019), (I-746)+(1.055)+(6.002), (I-746)+(1.055)+(7.001), (I-746)+(1.055)+(7.005), (I-746)+(1.055)+(9.002), (I-746)+(1.055)+(9.004), (I-746)+(1.055)+(14.001), (I-746)+(1.055)+(14.002), (I-746)+(1.055)+(15.008), (I-746)+(1.055)+(15.011), (I-746)+(1.055)+(15.012), (I-746)+(1.055)+(15.016), (I-746)+(1.055)+(15.025), (I-746)+(1.055)+(15.027), (I-746)+(1.055)+(15.047), (I-746)+(1.055)+(15.063), (I-746)+(1.055)+(15.064), (I-746)+(1.055)+(16.001), (I-746)+(1.055)+(16.005), (I-746)+(1.055)+(17.001), (I-746)+(1.055)+(17.002), (I-746)+(1.055)+(17.003), (I-746)+(1.055)+(17.008), (I-746)+(1.055)+(18.001),

(I-746)+(1.059)+(1.001), (I-746)+(1.059)+(1.002), (I-746)+(1.059)+(1.003), (I-746)+(1.059)+(1.004), (I-746)+(1.059)+(1.005), (I-746)+(1.059)+(1.006), (I-746)+(1.059)+(1.007), (I-746)+(1.059)+(1.010), (I-746)+(1.059)+(1.011), (I-746)+(1.059)+(1.012), (I-746)+(1.059)+(1.013), (I-746)+(1.059)+(1.017), (I-746)+(1.059)+(1.018), (I-746)+(1.059)+(1.020), (I-746)+(1.059)+(1.021), (I-746)+(1.059)+(1.026), (I-746)+(1.059)+(1.027), (I-746)+(1.059)+(1.055), (I-746)+(1.059)+(1.092), (I-746)+(1.059)+(2.001), (I-746)+(1.059)+(2.002), (I-746)+(1.059)+(2.003), (I-746)+(1.059)+(2.005), (I-746)+(1.059)+(2.007), (I-746)+(1.059)+(2.009), (I-746)+(1.059)+(2.010), (I-746)+(1.059)+(2.011), (I-746)+(1.059)+(2.012), (I-746)+(1.059)+(2.013), (I-746)+(1.059)+(2.014), (I-746)+(1.059)+(2.015), (I-746)+(1.059)+(2.016), (I-746)+(1.059)+(2.017), (I-746)+(1.059)+(2.018), (I-746)+(1.059)+(2.019), (I-746)+(1.059)+(2.021), (I-746)+(1.059)+(2.028), (I-746)+(1.059)+(2.030), (I-746)+(1.059)+(2.038), (I-746)+(1.059)+(3.003), (I-746)+(1.059)+(3.007), (I-746)+(1.059)+(3.012), (I-746)+(1.059)+(3.013), (I-746)+(1.059)+(3.016), (I-746)+(1.059)+(3.017), (I-746)+(1.059)+(3.020), (I-746)+(1.059)+(3.025), (I-746)+(1.059)+(3.026), (I-746)+(1.059)+(3.030), (I-746)+(1.059)+(3.031), (I-746)+(1.059)+(5.003), (I-746)+(1.059)+(5.004), (I-746)+(1.059)+(5.005), (I-746)+(1.059)+(5.008), (I-746)+(1.059)+(5.009), (I-746)+(1.059)+(5.011), (I-746)+(1.059)+(5.012), (I-746)+(1.059)+(5.013), (I-746)+(1.059)+(5.015), (I-746)+(1.059)+(5.018), (I-746)+(1.059)+(5.019), (I-746)+(1.059)+(6.002), (I-746)+(1.059)+(7.001), (I-746)+(1.059)+(7.005), (I-746)+(1.059)+(9.002), (I-746)+(1.059)+(9.004), (I-746)+(1.059)+(14.001), (I-746)+(1.059)+(14.002), (I-746)+(1.059)+(15.008), (I-746)+(1.059)+(15.011), (I-746)+(1.059)+(15.012), (I-746)+(1.059)+(15.016), (I-746)+(1.059)+(15.025), (I-746)+(1.059)+(15.027), (I-746)+(1.059)+(15.047), (I-746)+(1.059)+(15.063), (I-746)+(1.059)+(15.064), (I-746)+(1.059)+(16.001), (I-746)+(1.059)+(16.005), (I-746)+(1.059)+(17.001), (I-746)+(1.059)+(17.002), (I-746)+(1.059)+(17.003), (I-746)+(1.059)+(17.008), (I-746)+(1.059)+(18.001),

(I-746)+(1.092)+(1.001), (I-746)+(1.092)+(1.002), (I-746)+(1.092)+(1.003), (I-746)+(1.092)+(1.004), (I-746)+(1.092)+(1.005), (I-746)+(1.092)+(1.006), (I-746)+(1.092)+(1.007), (I-746)+(1.092)+(1.010), (I-746)+(1.092)+(1.011), (I-746)+(1.092)+(1.012), (I-746)+(1.092)+(1.013), (I-746)+(1.092)+(1.017), (I-746)+(1.092)+(1.018), (I-746)+(1.092)+(1.020), (I-746)+(1.092)+(1.021), (I-746)+(1.092)+(1.026), (I-746)+(1.092)+(1.027), (I-746)+(1.092)+(1.055), (I-746)+(1.092)+(1.059), (I-746)+(1.092)+(2.001), (I-746)+(1.092)+(2.002), (I-746)+(1.092)+(2.003), (I-746)+(1.092)+(2.005), (I-746)+(1.092)+(2.007), (I-746)+(1.092)+(2.009), (I-746)+(1.092)+(2.010), (I-746)+(1.092)+(2.011), (I-746)+(1.092)+(2.012), (I-746)+(1.092)+(2.013), (I-746)+(1.092)+(2.014), (I-746)+(1.092)+(2.015), (I-746)+(1.092)+(2.016), (I-746)+(1.092)+(2.017), (I-746)+(1.092)+(2.018), (I-746)+(1.092)+(2.019), (I-746)+(1.092)+(2.021), (I-746)+(1.092)+(2.028), (I-746)+(1.092)+(2.030), (I-746)+(1.092)+(2.038), (I-746)+(1.092)+(3.003), (I-746)+(1.092)+(3.007), (I-746)+(1.092)+(3.012), (I-746)+(1.092)+(3.013), (I-746)+(1.092)+(3.016), (I-746)+(1.092)+(3.017), (I-746)+(1.092)+(3.020), (I-746)+(1.092)+(3.025), (I-746)+(1.092)+(3.026), (I-746)+(1.092)+(3.030), (I-746)+(1.092)+(3.031), (I-746)+(1.092)+(5.003), (I-746)+(1.092)+(5.004), (I-746)+(1.092)+(5.005), (I-746)+(1.092)+(5.008), (I-746)+(1.092)+(5.009), (I-746)+(1.092)+(5.011), (I-746)+(1.092)+(5.012), (I-746)+(1.092)+(5.013), (I-746)+(1.092)+(5.015), (I-746)+(1.092)+(5.018), (I-746)+(1.092)+(5.019), (I-746)+(1.092)+(6.002), (I-746)+(1.092)+(7.001), (I-746)+(1.092)+(7.005), (I-746)+(1.092)+(9.002), (I-746)+(1.092)+(9.004), (I-746)+(1.092)+(14.001), (I-746)+(1.092)+(14.002), (I-746)+(1.092)+(15.008), (I-746)+(1.092)+(15.011), (I-746)+(1.092)+(15.012), (I-746)+(1.092)+(15.016), (I-746)+(1.092)+(15.025), (I-746)+(1.092)+(15.027), (I-746)+(1.092)+(15.047), (I-746)+(1.092)+(15.063), (I-746)+(1.092)+(15.064), (I-746)+(1.092)+(16.001), (I-746)+(1.092)+(16.005), (I-746)+(1.092)+(17.001), (I-746)+(1.092)+(17.002), (I-746)+(1.092)+(17.003), (I-746)+(1.092)+(17.008), (I-746)+(1.092)+(18.001),

(I-746)+(2.001)+(3.003), (I-746)+(2.001)+(3.007), (I-746)+(2.001)+(3.012), (I-746)+(2.001)+(3.013), (I-746)+(2.001)+(3.016), (I-746)+(2.001)+(3.017), (I-746)+(2.001)+(3.020), (I-746)+(2.001)+(3.025), (I-746)+(2.001)+(3.026), (I-746)+(2.001)+(3.030), (I-746)+(2.001)+(3.031), (I-746)+(2.001)+(5.003), (I-746)+(2.001)+(5.004), (I-746)+(2.001)+(5.005), (I-746)+(2.001)+(5.008), (I-746)+(2.001)+(5.009), (I-746)+(2.001)+(5.011), (I-746)+(2.001)+(5.012), (I-746)+(2.001)+(5.013), (I-746)+(2.001)+(5.015), (I-746)+(2.001)+(5.018), (I-746)+(2.001)+(5.019), (I-746)+(2.001)+(6.002), (I-746)+(2.001)+(7.001), (I-746)+(2.001)+(7.005), (I-746)+(2.001)+(9.002), (I-746)+(2.001)+(9.004), (I-746)+(2.001)+(14.001), (I-746)+(2.001)+(14.002), (I-746)+(2.001)+(15.008), (I-746)+(2.001)+(15.011), (I-746)+(2.001)+(15.012), (I-746)+(2.001)+(15.016), (I-746)+(2.001)+(15.025), (I-746)+(2.001)+(15.027), (I-746)+(2.001)+(15.047), (I-746)+(2.001)+(15.063), (I-746)+(2.001)+(15.064), (I-746)+(2.001)+(16.001), (I-746)+(2.001)+(16.005), (I-746)+(2.001)+(17.001), (I-746)+(2.001)+(17.002), (I-746)+(2.001)+(17.003), (I-746)+(2.001)+(17.008), (I-746)+(2.001)+(18.001),

(I-746)+(2.002)+(3.003), (I-746)+(2.002)+(3.007), (I-746)+(2.002)+(3.012), (I-746)+(2.002)+(3.013), (I-746)+(2.002)+(3.016), (I-746)+(2.002)+(3.017), (I-746)+(2.002)+(3.020), (I-746)+(2.002)+(3.025), (I-746)+(2.002)+(3.026), (I-746)+(2.002)+(3.030), (I-746)+(2.002)+(3.031), (I-746)+(2.002)+(5.003), (I-746)+(2.002)+(5.004), (I-746)+(2.002)+(5.005), (I-746)+(2.002)+(5.008), (I-746)+(2.002)+(5.009), (I-746)+(2.002)+(5.011), (I-746)+(2.002)+(5.012), (I-746)+(2.002)+(5.013), (I-746)+(2.002)+(5.015), (I-746)+(2.002)+(5.018), (I-746)+(2.002)+(5.019), (I-746)+(2.002)+(6.002), (I-746)+(2.002)+(7.001), (I-746)+(2.002)+(7.005), (I-746)+(2.002)+(9.002), (I-746)+(2.002)+(9.004), (I-746)+(2.002)+(14.001), (I-746)+(2.002)+(14.002), (I-746)+(2.002)+(15.008), (I-746)+(2.002)+(15.011), (I-746)+(2.002)+(15.012), (I-746)+(2.002)+(15.016), (I-746)+(2.002)+(15.025), (I-746)+(2.002)+(15.027), (I-746)+(2.002)+(15.047), (I-746)+(2.002)+(15.063), (I-746)+(2.002)+(15.064), (I-746)+(2.002)+(16.001), (I-746)+(2.002)+(16.005), (I-746)+(2.002)+(17.001), (I-746)+(2.002)+(17.002), (I-746)+(2.002)+(17.003), (I-746)+(2.002)+(17.008), (I-746)+(2.002)+(18.001),

(I-746)+(2.003)+(3.003), (I-746)+(2.003)+(3.007), (I-746)+(2.003)+(3.012), (I-746)+(2.003)+(3.013), (I-746)+(2.003)+(3.016), (I-746)+(2.003)+(3.017), (I-746)+(2.003)+(3.020), (I-746)+(2.003)+(3.025), (I-746)+(2.003)+(3.026), (I-746)+(2.003)+(3.030), (I-746)+(2.003)+(3.031), (I-746)+(2.003)+(5.003), (I-746)+(2.003)+(5.004), (I-746)+(2.003)+(5.005), (I-746)+(2.003)+(5.008), (I-746)+(2.003)+(5.009), (I-746)+(2.003)+(5.011), (I-746)+(2.003)+(5.012), (I-746)+(2.003)+(5.013), (I-746)+(2.003)+(5.015), (I-746)+(2.003)+(5.018), (I-746)+(2.003)+(5.019), (I-746)+(2.003)+(6.002), (I-746)+(2.003)+(7.001), (I-746)+(2.003)+(7.005), (I-746)+(2.003)+(9.002), (I-746)+(2.003)+(9.004), (I-746)+(2.003)+(14.001), (I-746)+(2.003)+(14.002), (I-746)+(2.003)+(15.008), (I-746)+(2.003)+(15.011), (I-746)+(2.003)+(15.012), (I-746)+(2.003)+(15.016), (I-746)+(2.003)+(15.025), (I-746)+(2.003)+(15.027), (I-746)+(2.003)+(15.047), (I-746)+(2.003)+(15.063), (I-746)+(2.003)+(15.064), (I-746)+(2.003)+(16.001), (I-746)+(2.003)+(16.005), (I-746)+(2.003)+(17.001), (I-746)+(2.003)+(17.002), (I-746)+(2.003)+(17.003), (I-746)+(2.003)+(17.008), (I-746)+(2.003)+(18.001),

(I-746)+(2.005)+(3.003), (I-746)+(2.005)+(3.007), (I-746)+(2.005)+(3.012), (I-746)+(2.005)+(3.013), (I-746)+(2.005)+(3.016), (I-746)+(2.005)+(3.017), (I-746)+(2.005)+(3.020), (I-746)+(2.005)+(3.025), (I-746)+(2.005)+(3.026), (I-746)+(2.005)+(3.030), (I-746)+(2.005)+(3.031), (I-746)+(2.005)+(5.003), (I-746)+(2.005)+(5.004), (I-746)+(2.005)+(5.005), (I-746)+(2.005)+(5.008), (I-746)+(2.005)+(5.009), (I-746)+(2.005)+(5.011), (I-746)+(2.005)+(5.012), (I-746)+(2.005)+(5.013), (I-746)+(2.005)+(5.015), (I-746)+(2.005)+(5.018), (I-746)+(2.005)+(5.019), (I-746)+(2.005)+(6.002), (I-746)+(2.005)+(7.001), (I-746)+(2.005)+(7.005), (I-746)+(2.005)+(9.002), (I-746)+(2.005)+(9.004), (I-746)+(2.005)+(14.001), (I-746)+(2.005)+(14.002), (I-746)+(2.005)+(15.008), (I-746)+(2.005)+(15.011), (I-746)+(2.005)+(15.012), (I-746)+(2.005)+(15.016), (I-746)+(2.005)+(15.025), (I-746)+(2.005)+(15.027), (I-746)+(2.005)+(15.047), (I-746)+(2.005)+(15.063), (I-746)+(2.005)+(15.064), (I-746)+(2.005)+(16.001), (I-746)+(2.005)+(16.005), (I-746)+(2.005)+(17.001), (I-746)+(2.005)+(17.002), (I-746)+(2.005)+(17.003), (I-746)+(2.005)+(17.008), (I-746)+(2.005)+(18.001),

(I-746)+(2.007)+(3.003), (I-746)+(2.007)+(3.007), (I-746)+(2.007)+(3.012), (I-746)+(2.007)+(3.013), (I-746)+(2.007)+(3.016), (I-746)+(2.007)+(3.017), (I-746)+(2.007)+(3.020), (I-746)+(2.007)+(3.025), (I-746)+(2.007)+(3.026), (I-746)+(2.007)+(3.030), (I-746)+(2.007)+(3.031), (I-746)+(2.007)+(5.003), (I-746)+(2.007)+(5.004), (I-746)+(2.007)+(5.005), (I-746)+(2.007)+(5.008), (I-746)+(2.007)+(5.009), (I-746)+(2.007)+(5.011), (I-746)+(2.007)+(5.012), (I-746)+(2.007)+(5.013), (I-746)+(2.007)+(5.015), (I-746)+(2.007)+(5.018), (I-746)+(2.007)+(5.019), (I-746)+(2.007)+(6.002), (I-746)+(2.007)+(7.001), (I-746)+(2.007)+(7.005), (I-746)+(2.007)+(9.002), (I-746)+(2.007)+(9.004), (I-746)+(2.007)+(14.001), (I-746)+(2.007)+(14.002), (I-746)+(2.007)+(15.008), (I-746)+(2.007)+(15.011), (I-746)+(2.007)+(15.012), (I-746)+(2.007)+(15.016), (I-746)+(2.007)+(15.025), (I-746)+(2.007)+(15.027), (I-746)+(2.007)+(15.047), (I-746)+(2.007)+(15.063), (I-746)+(2.007)+(15.064), (I-746)+(2.007)+(16.001), (I-746)+(2.007)+(16.005), (I-746)+(2.007)+(17.001), (I-746)+(2.007)+(17.002), (I-746)+(2.007)+(17.003), (I-746)+(2.007)+(17.008), (I-746)+(2.007)+(18.001),

(I-746)+(2.009)+(3.003), (I-746)+(2.009)+(3.007), (I-746)+(2.009)+(3.012), (I-746)+(2.009)+(3.013), (I-746)+(2.009)+(3.016), (I-746)+(2.009)+(3.017), (I-746)+(2.009)+(3.020), (I-746)+(2.009)+(3.025), (I-746)+(2.009)+(3.026), (I-746)+(2.009)+(3.030), (I-746)+(2.009)+(3.031), (I-746)+(2.009)+(5.003), (I-746)+(2.009)+(5.004), (I-746)+(2.009)+(5.005), (I-746)+(2.009)+(5.008), (I-746)+(2.009)+(5.009), (I-746)+(2.009)+(5.011), (I-746)+(2.009)+(5.012), (I-746)+(2.009)+(5.013), (I-746)+(2.009)+(5.015), (I-746)+(2.009)+(5.018), (I-746)+(2.009)+(5.019), (I-746)+(2.009)+(6.002), (I-746)+(2.009)+(7.001), (I-746)+(2.009)+(7.005), (I-746)+(2.009)+(9.002), (I-746)+(2.009)+(9.004), (I-746)+(2.009)+(14.001), (I-746)+(2.009)+(14.002), (I-746)+(2.009)+(15.008), (I-746)+(2.009)+(15.011), (I-746)+(2.009)+(15.012), (I-746)+(2.009)+(15.016), (I-746)+(2.009)+(15.025), (I-746)+(2.009)+(15.027), (I-746)+(2.009)+(15.047), (I-746)+(2.009)+(15.063), (I-746)+(2.009)+(15.064), (I-746)+(2.009)+(16.001), (I-746)+(2.009)+(16.005), (I-746)+(2.009)+(17.001), (I-746)+(2.009)+(17.002), (I-746)+(2.009)+(17.003), (I-746)+(2.009)+(17.008), (I-746)+(2.009)+(18.001),

(I-746)+(2.010)+(3.003), (I-746)+(2.010)+(3.007), (I-746)+(2.010)+(3.012), (I-746)+(2.010)+(3.013), (I-746)+(2.010)+(3.016), (I-746)+(2.010)+(3.017), (I-746)+(2.010)+(3.020), (I-746)+(2.010)+(3.025), (I-746)+(2.010)+(3.026), (I-746)+(2.010)+(3.030), (I-746)+(2.010)+(3.031), (I-746)+(2.010)+(5.003), (I-746)+(2.010)+(5.004), (I-746)+(2.010)+(5.005), (I-746)+(2.010)+(5.008), (I-746)+(2.010)+(5.009), (I-746)+(2.010)+(5.011), (I-746)+(2.010)+(5.012), (I-746)+(2.010)+(5.013), (I-746)+(2.010)+(5.015), (I-746)+(2.010)+(5.018), (I-746)+(2.010)+(5.019), (I-746)+(2.010)+(6.002), (I-746)+(2.010)+(7.001), (I-746)+(2.010)+(7.005), (I-746)+(2.010)+(9.002), (I-746)+(2.010)+(9.004), (I-746)+(2.010)+(14.001), (I-746)+(2.010)+(14.002), (I-746)+(2.010)+(15.008), (I-746)+(2.010)+(15.011), (I-746)+(2.010)+(15.012), (I-746)+(2.010)+(15.016), (I-746)+(2.010)+(15.025), (I-746)+(2.010)+(15.027), (I-746)+(2.010)+(15.047), (I-746)+(2.010)+(15.063), (I-746)+(2.010)+(15.064), (I-746)+(2.010)+(16.001), (I-746)+(2.010)+(16.005), (I-746)+(2.010)+(17.001), (I-746)+(2.010)+(17.002), (I-746)+(2.010)+(17.003), (I-746)+(2.010)+(17.008), (I-746)+(2.010)+(18.001),

(I-746)+(2.011)+(3.003), (I-746)+(2.011)+(3.007), (I-746)+(2.011)+(3.012), (I-746)+(2.011)+(3.013), (I-746)+(2.011)+(3.016), (I-746)+(2.011)+(3.017), (I-746)+(2.011)+(3.020), (I-746)+(2.011)+(3.025), (I-746)+(2.011)+(3.026), (I-746)+(2.011)+(3.030), (I-746)+(2.011)+(3.031), (I-746)+(2.011)+(5.003), (I-746)+(2.011)+(5.004), (I-746)+(2.011)+(5.005), (I-746)+(2.011)+(5.008), (I-746)+(2.011)+(5.009), (I-746)+(2.011)+(5.011), (I-746)+(2.011)+(5.012), (I-746)+(2.011)+(5.013), (I-746)+(2.011)+(5.015), (I-746)+(2.011)+(5.018), (I-746)+(2.011)+(5.019), (I-746)+(2.011)+(6.002), (I-746)+(2.011)+(7.001), (I-746)+(2.011)+(7.005), (I-746)+(2.011)+(9.002), (I-746)+(2.011)+(9.004), (I-746)+(2.011)+(14.001), (I-746)+(2.011)+(14.002), (I-746)+(2.011)+(15.008), (I-746)+(2.011)+(15.011), (I-746)+(2.011)+(15.012), (I-746)+(2.011)+(15.016), (I-746)+(2.011)+(15.025), (I-746)+(2.011)+(15.027), (I-746)+(2.011)+(15.047), (I-746)+(2.011)+(15.063), (I-746)+(2.011)+(15.064), (I-746)+(2.011)+(16.001), (I-746)+(2.011)+(16.005), (I-746)+(2.011)+(17.001), (I-746)+(2.011)+(17.002), (I-746)+(2.011)+(17.003), (I-746)+(2.011)+(17.008), (I-746)+(2.011)+(18.001),

(I-746)+(2.012)+(3.003), (I-746)+(2.012)+(3.007), (I-746)+(2.012)+(3.012), (I-746)+(2.012)+(3.013), (I-746)+(2.012)+(3.016), (I-746)+(2.012)+(3.017), (I-746)+(2.012)+(3.020), (I-746)+(2.012)+(3.025), (I-746)+(2.012)+(3.026), (I-746)+(2.012)+(3.030), (I-746)+(2.012)+(3.031), (I-746)+(2.012)+(5.003), (I-746)+(2.012)+(5.004), (I-746)+(2.012)+(5.005), (I-746)+(2.012)+(5.008), (I-746)+(2.012)+(5.009), (I-746)+(2.012)+(5.011), (I-746)+(2.012)+(5.012), (I-746)+(2.012)+(5.013), (I-746)+(2.012)+(5.015), (I-746)+(2.012)+(5.018), (I-746)+(2.012)+(5.019), (I-746)+(2.012)+(6.002), (I-746)+(2.012)+(7.001), (I-746)+(2.012)+(7.005), (I-746)+(2.012)+(9.002), (I-746)+(2.012)+(9.004), (I-746)+(2.012)+(14.001), (I-746)+(2.012)+(14.002), (I-746)+(2.012)+(15.008), (I-746)+(2.012)+(15.011), (I-746)+(2.012)+(15.012), (I-746)+(2.012)+(15.016), (I-746)+(2.012)+(15.025), (I-746)+(2.012)+(15.027), (I-746)+(2.012)+(15.047), (I-746)+(2.012)+(15.063), (I-746)+(2.012)+(15.064), (I-746)+(2.012)+(16.001), (I-746)+(2.012)+(16.005), (I-746)+(2.012)+(17.001), (I-746)+(2.012)+(17.002), (I-746)+(2.012)+(17.003), (I-746)+(2.012)+(17.008), (I-746)+(2.012)+(18.001),

(I-746)+(2.013)+(3.003), (I-746)+(2.013)+(3.007), (I-746)+(2.013)+(3.012), (I-746)+(2.013)+(3.013), (I-746)+(2.013)+(3.016), (I-746)+(2.013)+(3.017), (I-746)+(2.013)+(3.020), (I-746)+(2.013)+(3.025), (I-746)+(2.013)+(3.026), (I-746)+(2.013)+(3.030), (I-746)+(2.013)+(3.031), (I-746)+(2.013)+(5.003), (I-746)+(2.013)+(5.004), (I-746)+(2.013)+(5.005), (I-746)+(2.013)+(5.008), (I-746)+(2.013)+(5.009), (I-746)+(2.013)+(5.011), (I-746)+(2.013)+(5.012), (I-746)+(2.013)+(5.013), (I-746)+(2.013)+(5.015), (I-746)+(2.013)+(5.018), (I-746)+(2.013)+(5.019), (I-746)+(2.013)+(6.002), (I-746)+(2.013)+(7.001), (I-746)+(2.013)+(7.005), (I-746)+(2.013)+(9.002), (I-746)+(2.013)+(9.004), (I-746)+(2.013)+(14.001), (I-746)+(2.013)+(14.002), (I-746)+(2.013)+(15.008), (I-746)+(2.013)+(15.011), (I-746)+(2.013)+(15.012), (I-746)+(2.013)+(15.016), (I-746)+(2.013)+(15.025), (I-746)+(2.013)+(15.027), (I-746)+(2.013)+(15.047), (I-746)+(2.013)+(15.063), (I-746)+(2.013)+(15.064), (I-746)+(2.013)+(16.001), (I-746)+(2.013)+(16.005), (I-746)+(2.013)+(17.001), (I-746)+(2.013)+(17.002), (I-746)+(2.013)+(17.003), (I-746)+(2.013)+(17.008), (I-746)+(2.013)+(18.001),

(I-746)+(2.014)+(3.003), (I-746)+(2.014)+(3.007), (I-746)+(2.014)+(3.012), (I-746)+(2.014)+(3.013), (I-746)+(2.014)+(3.016), (I-746)+(2.014)+(3.017), (I-746)+(2.014)+(3.020), (I-746)+(2.014)+(3.025), (I-746)+(2.014)+(3.026), (I-746)+(2.014)+(3.030), (I-746)+(2.014)+(3.031), (I-746)+(2.014)+(5.003), (I-746)+(2.014)+(5.004), (I-746)+(2.014)+(5.005), (I-746)+(2.014)+(5.008), (I-746)+(2.014)+(5.009), (I-746)+(2.014)+(5.011), (I-746)+(2.014)+(5.012), (I-746)+(2.014)+(5.013), (I-746)+(2.014)+(5.015), (I-746)+(2.014)+(5.018), (I-746)+(2.014)+(5.019), (I-746)+(2.014)+(6.002), (I-746)+(2.014)+(7.001), (I-746)+(2.014)+(7.005), (I-746)+(2.014)+(9.002), (I-746)+(2.014)+(9.004), (I-746)+(2.014)+(14.001), (I-746)+(2.014)+(14.002), (I-746)+(2.014)+(15.008), (I-746)+(2.014)+(15.011), (I-746)+(2.014)+(15.012), (I-746)+(2.014)+(15.016), (I-746)+(2.014)+(15.025), (I-746)+(2.014)+(15.027), (I-746)+(2.014)+(15.047), (I-746)+(2.014)+(15.063), (I-746)+(2.014)+(15.064), (I-746)+(2.014)+(16.001), (I-746)+(2.014)+(16.005), (I-746)+(2.014)+(17.001), (I-746)+(2.014)+(17.002), (I-746)+(2.014)+(17.003), (I-746)+(2.014)+(17.008), (I-746)+(2.014)+(18.001),

(I-746)+(2.015)+(3.003), (I-746)+(2.015)+(3.007), (I-746)+(2.015)+(3.012), (I-746)+(2.015)+(3.013), (I-746)+(2.015)+(3.016), (I-746)+(2.015)+(3.017), (I-746)+(2.015)+(3.020), (I-746)+(2.015)+(3.025), (I-746)+(2.015)+(3.026), (I-746)+(2.015)+(3.030), (I-746)+(2.015)+(3.031), (I-746)+(2.015)+(5.003), (I-746)+(2.015)+(5.004), (I-746)+(2.015)+(5.005), (I-746)+(2.015)+(5.008), (I-746)+(2.015)+(5.009), (I-746)+(2.015)+(5.011), (I-746)+(2.015)+(5.012), (I-746)+(2.015)+(5.013), (I-746)+(2.015)+(5.015), (I-746)+(2.015)+(5.018), (I-746)+(2.015)+(5.019), (I-746)+(2.015)+(6.002), (I-746)+(2.015)+(7.001), (I-746)+(2.015)+(7.005), (I-746)+(2.015)+(9.002), (I-746)+(2.015)+(9.004), (I-746)+(2.015)+(14.001), (I-746)+(2.015)+(14.002), (I-746)+(2.015)+(15.008), (I-746)+(2.015)+(15.011), (I-746)+(2.015)+(15.012), (I-746)+(2.015)+(15.016), (I-746)+(2.015)+(15.025), (I-746)+(2.015)+(15.027), (I-746)+(2.015)+(15.047), (I-746)+(2.015)+(15.063), (I-746)+(2.015)+(15.064), (I-746)+(2.015)+(16.001), (I-746)+(2.015)+(16.005), (I-746)+(2.015)+(17.001), (I-746)+(2.015)+(17.002), (I-746)+(2.015)+(17.003), (I-746)+(2.015)+(17.008), (I-746)+(2.015)+(18.001),

(I-746)+(2.016)+(3.003), (I-746)+(2.016)+(3.007), (I-746)+(2.016)+(3.012), (I-746)+(2.016)+(3.013), (I-746)+(2.016)+(3.016), (I-746)+(2.016)+(3.017), (I-746)+(2.016)+(3.020), (I-746)+(2.016)+(3.025), (I-746)+(2.016)+(3.026), (I-746)+(2.016)+(3.030), (I-746)+(2.016)+(3.031), (I-746)+(2.016)+(5.003), (I-746)+(2.016)+(5.004), (I-746)+(2.016)+(5.005), (I-746)+(2.016)+(5.008), (I-746)+(2.016)+(5.009), (I-746)+(2.016)+(5.011), (I-746)+(2.016)+(5.012), (I-746)+(2.016)+(5.013), (I-746)+(2.016)+(5.015), (I-746)+(2.016)+(5.018), (I-746)+(2.016)+(5.019), (I-746)+(2.016)+(6.002), (I-746)+(2.016)+(7.001), (I-746)+(2.016)+(7.005), (I-746)+(2.016)+(9.002), (I-746)+(2.016)+(9.004), (I-746)+(2.016)+(14.001), (I-746)+(2.016)+(14.002), (I-746)+(2.016)+(15.008), (I-746)+(2.016)+(15.011), (I-746)+(2.016)+(15.012), (I-746)+(2.016)+(15.016), (I-746)+(2.016)+(15.025), (I-746)+(2.016)+(15.027), (I-746)+(2.016)+(15.047), (I-746)+(2.016)+(15.063), (I-746)+(2.016)+(15.064), (I-746)+(2.016)+(16.001), (I-746)+(2.016)+(16.005), (I-746)+(2.016)+(17.001), (I-746)+(2.016)+(17.002), (I-746)+(2.016)+(17.003), (I-746)+(2.016)+(17.008), (I-746)+(2.016)+(18.001),

(I-746)+(2.017)+(3.003), (I-746)+(2.017)+(3.007), (I-746)+(2.017)+(3.012), (I-746)+(2.017)+(3.013), (I-746)+(2.017)+(3.016), (I-746)+(2.017)+(3.017), (I-746)+(2.017)+(3.020), (I-746)+(2.017)+(3.025), (I-746)+(2.017)+(3.026), (I-746)+(2.017)+(3.030), (I-746)+(2.017)+(3.031), (I-746)+(2.017)+(5.003), (I-746)+(2.017)+(5.004), (I-746)+(2.017)+(5.005), (I-746)+(2.017)+(5.008), (I-746)+(2.017)+(5.009), (I-746)+(2.017)+(5.011), (I-746)+(2.017)+(5.012), (I-746)+(2.017)+(5.013), (I-746)+(2.017)+(5.015), (I-746)+(2.017)+(5.018), (I-746)+(2.017)+(5.019), (I-746)+(2.017)+(6.002), (I-746)+(2.017)+(7.001), (I-746)+(2.017)+(7.005), (I-746)+(2.017)+(9.002), (I-746)+(2.017)+(9.004), (I-746)+(2.017)+(14.001), (I-746)+(2.017)+(14.002), (I-746)+(2.017)+(15.008), (I-746)+(2.017)+(15.011), (I-746)+(2.017)+(15.012), (I-746)+(2.017)+(15.016), (I-746)+(2.017)+(15.025), (I-746)+(2.017)+(15.027), (I-746)+(2.017)+(15.047), (I-746)+(2.017)+(15.063), (I-746)+(2.017)+(15.064), (I-746)+(2.017)+(16.001), (I-746)+(2.017)+(16.005), (I-746)+(2.017)+(17.001), (I-746)+(2.017)+(17.002), (I-746)+(2.017)+(17.003), (I-746)+(2.017)+(17.008), (I-746)+(2.017)+(18.001),

(I-746)+(2.018)+(3.003), (I-746)+(2.018)+(3.007), (I-746)+(2.018)+(3.012), (I-746)+(2.018)+(3.013), (I-746)+(2.018)+(3.016), (I-746)+(2.018)+(3.017), (I-746)+(2.018)+(3.020), (I-746)+(2.018)+(3.025), (I-746)+(2.018)+(3.026), (I-746)+(2.018)+(3.030), (I-746)+(2.018)+(3.031), (I-746)+(2.018)+(5.003), (I-746)+(2.018)+(5.004), (I-746)+(2.018)+(5.005), (I-746)+(2.018)+(5.008), (I-746)+(2.018)+(5.009), (I-746)+(2.018)+(5.011), (I-746)+(2.018)+(5.012), (I-746)+(2.018)+(5.013), (I-746)+(2.018)+(5.015), (I-746)+(2.018)+(5.018), (I-746)+(2.018)+(5.019), (I-746)+(2.018)+(6.002), (I-746)+(2.018)+(7.001), (I-746)+(2.018)+(7.005), (I-746)+(2.018)+(9.002), (I-746)+(2.018)+(9.004), (I-746)+(2.018)+(14.001), (I-746)+(2.018)+(14.002), (I-746)+(2.018)+(15.008), (I-746)+(2.018)+(15.011), (I-746)+(2.018)+(15.012), (I-746)+(2.018)+(15.016), (I-746)+(2.018)+(15.025), (I-746)+(2.018)+(15.027), (I-746)+(2.018)+(15.047), (I-746)+(2.018)+(15.063), (I-746)+(2.018)+(15.064), (I-746)+(2.018)+(16.001), (I-746)+(2.018)+(16.005), (I-746)+(2.018)+(17.001), (I-746)+(2.018)+(17.002), (I-746)+(2.018)+(17.003), (I-746)+(2.018)+(17.008), (I-746)+(2.018)+(18.001),

(I-746)+(2.019)+(3.003), (I-746)+(2.019)+(3.007), (I-746)+(2.019)+(3.012), (I-746)+(2.019)+(3.013), (I-746)+(2.019)+(3.016), (I-746)+(2.019)+(3.017), (I-746)+(2.019)+(3.020), (I-746)+(2.019)+(3.025), (I-746)+(2.019)+(3.026), (I-746)+(2.019)+(3.030), (I-746)+(2.019)+(3.031), (I-746)+(2.019)+(5.003), (I-746)+(2.019)+(5.004), (I-746)+(2.019)+(5.005), (I-746)+(2.019)+(5.008), (I-746)+(2.019)+(5.009), (I-746)+(2.019)+(5.011), (I-746)+(2.019)+(5.012), (I-746)+(2.019)+(5.013), (I-746)+(2.019)+(5.015), (I-746)+(2.019)+(5.018), (I-746)+(2.019)+(5.019), (I-746)+(2.019)+(6.002), (I-746)+(2.019)+(7.001), (I-746)+(2.019)+(7.005), (I-746)+(2.019)+(9.002), (I-746)+(2.019)+(9.004), (I-746)+(2.019)+(14.001), (I-746)+(2.019)+(14.002), (I-746)+(2.019)+(15.008), (I-746)+(2.019)+(15.011), (I-746)+(2.019)+(15.012), (I-746)+(2.019)+(15.016), (I-746)+(2.019)+(15.025), (I-746)+(2.019)+(15.027), (I-746)+(2.019)+(15.047), (I-746)+(2.019)+(15.063), (I-746)+(2.019)+(15.064), (I-746)+(2.019)+(16.001), (I-746)+(2.019)+(16.005), (I-746)+(2.019)+(17.001), (I-746)+(2.019)+(17.002), (I-746)+(2.019)+(17.003), (I-746)+(2.019)+(17.008), (I-746)+(2.019)+(18.001),

(I-746)+(2.021)+(3.003), (I-746)+(2.021)+(3.007), (I-746)+(2.021)+(3.012), (I-746)+(2.021)+(3.013), (I-746)+(2.021)+(3.016), (I-746)+(2.021)+(3.017), (I-746)+(2.021)+(3.020), (I-746)+(2.021)+(3.025), (I-746)+(2.021)+(3.026), (I-746)+(2.021)+(3.030), (I-746)+(2.021)+(3.031), (I-746)+(2.021)+(5.003), (I-746)+(2.021)+(5.004), (I-746)+(2.021)+(5.005), (I-746)+(2.021)+(5.008), (I-746)+(2.021)+(5.009), (I-746)+(2.021)+(5.011), (I-746)+(2.021)+(5.012), (I-746)+(2.021)+(5.013), (I-746)+(2.021)+(5.015), (I-746)+(2.021)+(5.018), (I-746)+(2.021)+(5.019), (I-746)+(2.021)+(6.002), (I-746)+(2.021)+(7.001), (I-746)+(2.021)+(7.005), (I-746)+(2.021)+(9.002), (I-746)+(2.021)+(9.004), (I-746)+(2.021)+(14.001), (I-746)+(2.021)+(14.002), (I-746)+(2.021)+(15.008), (I-746)+(2.021)+(15.011), (I-746)+(2.021)+(15.012), (I-746)+(2.021)+(15.016), (I-746)+(2.021)+(15.025), (I-746)+(2.021)+(15.027), (I-746)+(2.021)+(15.047), (I-746)+(2.021)+(15.063), (I-746)+(2.021)+(15.064), (I-746)+(2.021)+(16.001), (I-746)+(2.021)+(16.005), (I-746)+(2.021)+(17.001), (I-746)+(2.021)+(17.002), (I-746)+(2.021)+(17.003), (I-746)+(2.021)+(17.008), (I-746)+(2.021)+(18.001),

(I-746)+(2.028)+(3.003), (I-746)+(2.028)+(3.007), (I-746)+(2.028)+(3.012), (I-746)+(2.028)+(3.013), (I-746)+(2.028)+(3.016), (I-746)+(2.028)+(3.017), (I-746)+(2.028)+(3.020), (I-746)+(2.028)+(3.025), (I-746)+(2.028)+(3.026), (I-746)+(2.028)+(3.030), (I-746)+(2.028)+(3.031), (I-746)+(2.028)+(5.003), (I-746)+(2.028)+(5.004), (I-746)+(2.028)+(5.005), (I-746)+(2.028)+(5.008), (I-746)+(2.028)+(5.009), (I-746)+(2.028)+(5.011), (I-746)+(2.028)+(5.012), (I-746)+(2.028)+(5.013), (I-746)+(2.028)+(5.015), (I-746)+(2.028)+(5.018), (I-746)+(2.028)+(5.019), (I-746)+(2.028)+(6.002), (I-746)+(2.028)+(7.001), (I-746)+(2.028)+(7.005), (I-746)+(2.028)+(9.002), (I-746)+(2.028)+(9.004), (I-746)+(2.028)+(14.001), (I-746)+(2.028)+(14.002), (I-746)+(2.028)+(15.008), (I-746)+(2.028)+(15.011), (I-746)+(2.028)+(15.012), (I-746)+(2.028)+(15.016), (I-746)+(2.028)+(15.025), (I-746)+(2.028)+(15.027), (I-746)+(2.028)+(15.047), (I-746)+(2.028)+(15.063), (I-746)+(2.028)+(15.064), (I-746)+(2.028)+(16.001), (I-746)+(2.028)+(16.005), (I-746)+(2.028)+(17.001), (I-746)+(2.028)+(17.002), (I-746)+(2.028)+(17.003), (I-746)+(2.028)+(17.008), (I-746)+(2.028)+(18.001),

(I-746)+(2.030)+(3.003), (I-746)+(2.030)+(3.007), (I-746)+(2.030)+(3.012), (I-746)+(2.030)+(3.013), (I-746)+(2.030)+(3.016), (I-746)+(2.030)+(3.017), (I-746)+(2.030)+(3.020), (I-746)+(2.030)+(3.025), (I-746)+(2.030)+(3.026), (I-746)+(2.030)+(3.030), (I-746)+(2.030)+(3.031), (I-746)+(2.030)+(5.003), (I-746)+(2.030)+(5.004), (I-746)+(2.030)+(5.005), (I-746)+(2.030)+(5.008), (I-746)+(2.030)+(5.009), (I-746)+(2.030)+(5.011), (I-746)+(2.030)+(5.012), (I-746)+(2.030)+(5.013), (I-746)+(2.030)+(5.015), (I-746)+(2.030)+(5.018), (I-746)+(2.030)+(5.019), (I-746)+(2.030)+(6.002), (I-746)+(2.030)+(7.001), (I-746)+(2.030)+(7.005), (I-746)+(2.030)+(9.002), (I-746)+(2.030)+(9.004), (I-746)+(2.030)+(14.001), (I-746)+(2.030)+(14.002), (I-746)+(2.030)+(15.008), (I-746)+(2.030)+(15.011), (I-746)+(2.030)+(15.012), (I-746)+(2.030)+(15.016), (I-746)+(2.030)+(15.025), (I-746)+(2.030)+(15.027), (I-746)+(2.030)+(15.047), (I-746)+(2.030)+(15.063), (I-746)+(2.030)+(15.064), (I-746)+(2.030)+(16.001), (I-746)+(2.030)+(16.005), (I-746)+(2.030)+(17.001), (I-746)+(2.030)+(17.002), (I-746)+(2.030)+(17.003), (I-746)+(2.030)+(17.008), (I-746)+(2.030)+(18.001),

(I-746)+(2.038)+(3.003), (I-746)+(2.038)+(3.007), (I-746)+(2.038)+(3.012), (I-746)+(2.038)+(3.013), (I-746)+(2.038)+(3.016), (I-746)+(2.038)+(3.017), (I-746)+(2.038)+(3.020), (I-746)+(2.038)+(3.025), (I-746)+(2.038)+(3.026), (I-746)+(2.038)+(3.030), (I-746)+(2.038)+(3.031), (I-746)+(2.038)+(5.003), (I-746)+(2.038)+(5.004), (I-746)+(2.038)+(5.005), (I-746)+(2.038)+(5.008), (I-746)+(2.038)+(5.009), (I-746)+(2.038)+(5.011), (I-746)+(2.038)+(5.012), (I-746)+(2.038)+(5.013), (I-746)+(2.038)+(5.015), (I-746)+(2.038)+(5.018), (I-746)+(2.038)+(5.019), (I-746)+(2.038)+(6.002), (I-746)+(2.038)+(7.001), (I-746)+(2.038)+(7.005), (I-746)+(2.038)+(9.002), (I-746)+(2.038)+(9.004), (I-746)+(2.038)+(14.001), (I-746)+(2.038)+(14.002), (I-746)+(2.038)+(15.008), (I-746)+(2.038)+(15.011), (I-746)+(2.038)+(15.012), (I-746)+(2.038)+(15.016), (I-746)+(2.038)+(15.025), (I-746)+(2.038)+(15.027), (I-746)+(2.038)+(15.047), (I-746)+(2.038)+(15.063), (I-746)+(2.038)+(15.064), (I-746)+(2.038)+(16.001), (I-746)+(2.038)+(16.005), (I-746)+(2.038)+(17.001), (I-746)+(2.038)+(17.002), (I-746)+(2.038)+(17.003), (I-746)+(2.038)+(17.008), (I-746)+(2.038)+(18.001).

(I-746)+(3.003)+(3.025), (I-746)+(3.003)+(3.030), (I-746)+(3.003)+(3.031), (I-746)+(3.003)+(5.003), (I-746)+(3.003)+(5.004), (I-746)+(3.003)+(5.005), (I-746)+(3.003)+(5.008), (I-746)+(3.003)+(5.009), (I-746)+(3.003)+(5.011), (I-746)+(3.003)+(5.012), (I-746)+(3.003)+(5.013), (I-746)+(3.003)+(5.015), (I-746)+(3.003)+(5.018), (I-746)+(3.003)+(5.019), (I-746)+(3.003)+(6.002), (I-746)+(3.003)+(7.001), (I-746)+(3.003)+(7.005), (I-746)+(3.003)+(9.002), (I-746)+(3.003)+(9.004), (I-746)+(3.003)+(14.001), (I-746)+(3.003)+(14.002), (I-746)+(3.003)+(15.008), (I-746)+(3.003)+(15.011), (I-746)+(3.003)+(15.012), (I-746)+(3.003)+(15.016), (I-746)+(3.003)+(15.025), (I-746)+(3.003)+(15.027), (I-746)+(3.003)+(15.047), (I-746)+(3.003)+(15.063), (I-746)+(3.003)+(15.064), (I-746)+(3.003)+(16.001), (I-746)+(3.003)+(16.005), (I-746)+(3.003)+(17.001), (I-746)+(3.003)+(17.002), (I-746)+(3.003)+(17.003), (I-746)+(3.003)+(17.008), (I-746)+(3.003)+(18.001),

(I-746)+(3.007)+(3.025), (I-746)+(3.007)+(3.030), (I-746)+(3.007)+(3.031), (I-746)+(3.007)+(5.003), (I-746)+(3.007)+(5.004), (I-746)+(3.007)+(5.005), (I-746)+(3.007)+(5.008), (I-746)+(3.007)+(5.009), (I-746)+(3.007)+(5.011), (I-746)+(3.007)+(5.012), (I-746)+(3.007)+(5.013), (I-746)+(3.007)+(5.015), (I-746)+(3.007)+(5.018), (I-746)+(3.007)+(5.019), (I-746)+(3.007)+(6.002), (I-746)+(3.007)+(7.001), (I-746)+(3.007)+(7.005), (I-746)+(3.007)+(9.002), (I-746)+(3.007)+(9.004), (I-746)+(3.007)+(14.001), (I-746)+(3.007)+(14.002), (I-746)+(3.007)+(15.008), (I-746)+(3.007)+(15.011), (I-746)+(3.007)+(15.012), (I-746)+(3.007)+(15.016), (I-746)+(3.007)+(15.025), (I-746)+(3.007)+(15.027), (I-746)+(3.007)+(15.047), (I-746)+(3.007)+(15.063), (I-746)+(3.007)+(15.064), (I-746)+(3.007)+(16.001), (I-746)+(3.007)+(16.005), (I-746)+(3.007)+(17.001), (I-746)+(3.007)+(17.002), (I-746)+(3.007)+(17.003), (I-746)+(3.007)+(17.008), (I-746)+(3.007)+(18.001),

(I-746)+(3.012)+(3.025), (I-746)+(3.012)+(3.030), (I-746)+(3.012)+(3.031), (I-746)+(3.012)+(5.003), (I-746)+(3.012)+(5.004), (I-746)+(3.012)+(5.005), (I-746)+(3.012)+(5.008), (I-746)+(3.012)+(5.009), (I-746)+(3.012)+(5.011), (I-746)+(3.012)+(5.012), (I-746)+(3.012)+(5.013), (I-746)+(3.012)+(5.015), (I-746)+(3.012)+(5.018), (I-746)+(3.012)+(5.019), (I-746)+(3.012)+(6.002), (I-746)+(3.012)+(7.001), (I-746)+(3.012)+(7.005), (I-746)+(3.012)+(9.002), (I-746)+(3.012)+(9.004), (I-746)+(3.012)+(14.001), (I-746)+(3.012)+(14.002), (I-746)+(3.012)+(15.008), (I-746)+(3.012)+(15.011), (I-746)+(3.012)+(15.012), (I-746)+(3.012)+(15.016), (I-746)+(3.012)+(15.025), (I-746)+(3.012)+(15.027), (I-746)+(3.012)+(15.047), (I-746)+(3.012)+(15.063), (I-746)+(3.012)+(15.064), (I-746)+(3.012)+(16.001), (I-746)+(3.012)+(16.005), (I-746)+(3.012)+(17.001), (I-746)+(3.012)+(17.002), (I-746)+(3.012)+(17.003), (I-746)+(3.012)+(17.008), (I-746)+(3.012)+(18.001),

(I-746)+(3.013)+(3.025), (I-746)+(3.013)+(3.030), (I-746)+(3.013)+(3.031), (I-746)+(3.013)+(5.003), (I-746)+(3.013)+(5.004), (I-746)+(3.013)+(5.005), (I-746)+(3.013)+(5.008), (I-746)+(3.013)+(5.009), (I-746)+(3.013)+(5.011), (I-746)+(3.013)+(5.012), (I-746)+(3.013)+(5.013), (I-746)+(3.013)+(5.015), (I-746)+(3.013)+(5.018), (I-746)+(3.013)+(5.019), (I-746)+(3.013)+(6.002), (I-746)+(3.013)+(7.001), (I-746)+(3.013)+(7.005), (I-746)+(3.013)+(9.002), (I-746)+(3.013)+(9.004), (I-746)+(3.013)+(14.001), (I-746)+(3.013)+(14.002), (I-746)+(3.013)+(15.008), (I-746)+(3.013)+(15.011), (I-746)+(3.013)+(15.012), (I-746)+(3.013)+(15.016), (I-746)+(3.013)+(15.025), (I-746)+(3.013)+(15.027), (I-746)+(3.013)+(15.047), (I-746)+(3.013)+(15.063), (I-746)+(3.013)+(15.064), (I-746)+(3.013)+(16.001), (I-746)+(3.013)+(16.005), (I-746)+(3.013)+(17.001), (I-746)+(3.013)+(17.002), (I-746)+(3.013)+(17.003), (I-746)+(3.013)+(17.008), (I-746)+(3.013)+(18.001),

(I-746)+(3.016)+(3.025), (I-746)+(3.016)+(3.030), (I-746)+(3.016)+(3.031), (I-746)+(3.016)+(5.003), (I-746)+(3.016)+(5.004), (I-746)+(3.016)+(5.005), (I-746)+(3.016)+(5.008), (I-746)+(3.016)+(5.009), (I-746)+(3.016)+(5.011), (I-746)+(3.016)+(5.012), (I-746)+(3.016)+(5.013), (I-746)+(3.016)+(5.015), (I-746)+(3.016)+(5.018), (I-746)+(3.016)+(5.019), (I-746)+(3.016)+(6.002), (I-746)+(3.016)+(7.001), (I-746)+(3.016)+(7.005), (I-746)+(3.016)+(9.002), (I-746)+(3.016)+(9.004), (I-746)+(3.016)+(14.001), (I-746)+(3.016)+(14.002), (I-746)+(3.016)+(15.008), (I-746)+(3.016)+(15.011), (I-746)+(3.016)+(15.012), (I-746)+(3.016)+(15.016), (I-746)+(3.016)+(15.025), (I-746)+(3.016)+(15.027), (I-746)+(3.016)+(15.047), (I-746)+(3.016)+(15.063), (I-746)+(3.016)+(15.064), (I-746)+(3.016)+(16.001), (I-746)+(3.016)+(16.005), (I-746)+(3.016)+(17.001), (I-746)+(3.016)+(17.002), (I-746)+(3.016)+(17.003), (I-746)+(3.016)+(17.008), (I-746)+(3.016)+(18.001),

(I-746)+(3.017)+(3.025), (I-746)+(3.017)+(3.030), (I-746)+(3.017)+(3.031), (I-746)+(3.017)+(5.003), (I-746)+(3.017)+(5.004), (I-746)+(3.017)+(5.005), (I-746)+(3.017)+(5.008), (I-746)+(3.017)+(5.009), (I-746)+(3.017)+(5.011), (I-746)+(3.017)+(5.012), (I-746)+(3.017)+(5.013), (I-746)+(3.017)+(5.015), (I-746)+(3.017)+(5.018), (I-746)+(3.017)+(5.019), (I-746)+(3.017)+(6.002), (I-746)+(3.017)+(7.001), (I-746)+(3.017)+(7.005), (I-746)+(3.017)+(9.002), (I-746)+(3.017)+(9.004), (I-746)+(3.017)+(14.001), (I-746)+(3.017)+(14.002), (I-746)+(3.017)+(15.008), (I-746)+(3.017)+(15.011), (I-746)+(3.017)+(15.012), (I-746)+(3.017)+(15.016), (I-746)+(3.017)+(15.025), (I-746)+(3.017)+(15.027), (I-746)+(3.017)+(15.047), (I-746)+(3.017)+(15.063), (I-746)+(3.017)+(15.064), (I-746)+(3.017)+(16.001), (I-746)+(3.017)+(16.005), (I-746)+(3.017)+(17.001), (I-746)+(3.017)+(17.002), (I-746)+(3.017)+(17.003), (I-746)+(3.017)+(17.008), (I-746)+(3.017)+(18.001),

(I-746)+(3.020)+(3.025), (I-746)+(3.020)+(3.030), (I-746)+(3.020)+(3.031), (I-746)+(3.020)+(5.003), (I-746)+(3.020)+(5.004), (I-746)+(3.020)+(5.005), (I-746)+(3.020)+(5.008), (I-746)+(3.020)+(5.009), (I-746)+(3.020)+(5.011), (I-746)+(3.020)+(5.012), (I-746)+(3.020)+(5.013), (I-746)+(3.020)+(5.015), (I-746)+(3.020)+(5.018), (I-746)+(3.020)+(5.019), (I-746)+(3.020)+(6.002), (I-746)+(3.020)+(7.001), (I-746)+(3.020)+(7.005), (I-746)+(3.020)+(9.002), (I-746)+(3.020)+(9.004), (I-746)+(3.020)+(14.001), (I-746)+(3.020)+(14.002), (I-746)+(3.020)+(15.008), (I-746)+(3.020)+(15.011), (I-746)+(3.020)+(15.012), (I-746)+(3.020)+(15.016), (I-746)+(3.020)+(15.025), (I-746)+(3.020)+(15.027), (I-746)+(3.020)+(15.047), (I-746)+(3.020)+(15.063), (I-746)+(3.020)+(15.064), (I-746)+(3.020)+(16.001), (I-746)+(3.020)+(16.005), (I-746)+(3.020)+(17.001), (I-746)+(3.020)+(17.002), (I-746)+(3.020)+(17.003), (I-746)+(3.020)+(17.008), (I-746)+(3.020)+(18.001),

(I-746)+(3.025)+(3.030), (I-746)+(3.025)+(3.031), (I-746)+(3.025)+(5.003), (I-746)+(3.025)+(5.004), (I-746)+(3.025)+(5.005), (I-746)+(3.025)+(5.008), (I-746)+(3.025)+(5.009), (I-746)+(3.025)+(5.011), (I-746)+(3.025)+(5.012), (I-746)+(3.025)+(5.013), (I-746)+(3.025)+(5.015), (I-746)+(3.025)+(5.018), (I-746)+(3.025)+(5.019), (I-746)+(3.025)+(6.002), (I-746)+(3.025)+(7.001), (I-746)+(3.025)+(7.005), (I-746)+(3.025)+(9.002), (I-746)+(3.025)+(9.004), (I-746)+(3.025)+(14.001), (I-746)+(3.025)+(14.002), (I-746)+(3.025)+(15.008), (I-746)+(3.025)+(15.011), (I-746)+(3.025)+(15.012), (I-746)+(3.025)+(15.016), (I-746)+(3.025)+(15.025), (I-746)+(3.025)+(15.027), (I-746)+(3.025)+(15.047), (I-746)+(3.025)+(15.063), (I-746)+(3.025)+(15.064), (I-746)+(3.025)+(16.001), (I-746)+(3.025)+(16.005), (I-746)+(3.025)+(17.001), (I-746)+(3.025)+(17.002), (I-746)+(3.025)+(17.003), (I-746)+(3.025)+(17.008), (I-746)+(3.025)+(18.001),

(I-746)+(3.026)+(3.025), (I-746)+(3.026)+(3.030), (I-746)+(3.026)+(3.031), (I-746)+(3.026)+(5.003), (I-746)+(3.026)+(5.004), (I-746)+(3.026)+(5.005), (I-746)+(3.026)+(5.008), (I-746)+(3.026)+(5.009), (I-746)+(3.026)+(5.011), (I-746)+(3.026)+(5.012), (I-746)+(3.026)+(5.013), (I-746)+(3.026)+(5.015), (I-746)+(3.026)+(5.018), (I-746)+(3.026)+(5.019), (I-746)+(3.026)+(6.002), (I-746)+(3.026)+(7.001), (I-746)+(3.026)+(7.005), (I-746)+(3.026)+(9.002), (I-746)+(3.026)+(9.004), (I-746)+(3.026)+(14.001), (I-746)+(3.026)+(14.002), (I-746)+(3.026)+(15.008), (I-746)+(3.026)+(15.011), (I-746)+(3.026)+(15.012), (I-746)+(3.026)+(15.016), (I-746)+(3.026)+(15.025), (I-746)+(3.026)+(15.027), (I-746)+(3.026)+(15.047), (I-746)+(3.026)+(15.063), (I-746)+(3.026)+(15.064), (I-746)+(3.026)+(16.001), (I-746)+(3.026)+(16.005), (I-746)+(3.026)+(17.001), (I-746)+(3.026)+(17.002), (I-746)+(3.026)+(17.003), (I-746)+(3.026)+(17.008), (I-746)+(3.026)+(18.001),

(I-746)+(3.030)+(3.025), (I-746)+(3.030)+(3.031), (I-746)+(3.030)+(5.003), (I-746)+(3.030)+(5.004), (I-746)+(3.030)+(5.005), (I-746)+(3.030)+(5.008), (I-746)+(3.030)+(5.009), (I-746)+(3.030)+(5.011), (I-746)+(3.030)+(5.012), (I-746)+(3.030)+(5.013), (I-746)+(3.030)+(5.015), (I-746)+(3.030)+(5.018), (I-746)+(3.030)+(5.019), (I-746)+(3.030)+(6.002), (I-746)+(3.030)+(7.001), (I-746)+(3.030)+(7.005), (I-746)+(3.030)+(9.002), (I-746)+(3.030)+(9.004), (I-746)+(3.030)+(14.001), (I-746)+(3.030)+(14.002), (I-746)+(3.030)+(15.008), (I-746)+(3.030)+(15.011), (I-746)+(3.030)+(15.012), (I-746)+(3.030)+(15.016), (I-746)+(3.030)+(15.025), (I-746)+(3.030)+(15.027), (I-746)+(3.030)+(15.047), (I-746)+(3.030)+(15.063), (I-746)+(3.030)+(15.064), (I-746)+(3.030)+(16.001), (I-746)+(3.030)+(16.005), (I-746)+(3.030)+(17.001), (I-746)+(3.030)+(17.002), (I-746)+(3.030)+(17.003), (I-746)+(3.030)+(17.008), (I-746)+(3.030)+(18.001),

(I-746)+(3.031)+(3.025), (I-746)+(3.031)+(3.030), (I-746)+(3.031)+(5.003), (I-746)+(3.031)+(5.004), (I-746)+(3.031)+(5.005), (I-746)+(3.031)+(5.008), (I-746)+(3.031)+(5.009), (I-746)+(3.031)+(5.011), (I-746)+(3.031)+(5.012), (I-746)+(3.031)+(5.013), (I-746)+(3.031)+(5.015), (I-746)+(3.031)+(5.018), (I-746)+(3.031)+(5.019), (I-746)+(3.031)+(6.002), (I-746)+(3.031)+(7.001), (I-746)+(3.031)+(7.005), (I-746)+(3.031)+(9.002), (I-746)+(3.031)+(9.004), (I-746)+(3.031)+(14.001), (I-746)+(3.031)+(14.002), (I-746)+(3.031)+(15.008), (I-746)+(3.031)+(15.011), (I-746)+(3.031)+(15.012), (I-746)+(3.031)+(15.016), (I-746)+(3.031)+(15.025), (I-746)+(3.031)+(15.027), (I-746)+(3.031)+(15.047), (I-746)+(3.031)+(15.063), (I-746)+(3.031)+(15.064), (I-746)+(3.031)+(16.001), (I-746)+(3.031)+(16.005), (I-746)+(3.031)+(17.001), (I-746)+(3.031)+(17.002), (I-746)+(3.031)+(17.003), (I-746)+(3.031)+(17.008), (I-746)+(3.031)+(18.001),

(I-746)+(5.003)+(9.002), (I-746)+(5.003)+(15.012), (I-746)+(5.003)+(15.016), (I-746)+(5.003)+(15.025), (I-746)+(5.003)+(15.027), (I-746)+(5.003)+(15.047), (I-746)+(5.003)+(15.063), (I-746)+(5.003)+(15.064),

(I-746)+(5.004)+(9.002), (I-746)+(5.004)+(15.012), (I-746)+(5.004)+(15.016), (I-746)+(5.004)+(15.025), (I-746)+(5.004)+(15.027), (I-746)+(5.004)+(15.047), (I-746)+(5.004)+(15.063), (I-746)+(5.004)+(15.064),

(I-746)+(5.005)+(9.002), (I-746)+(5.005)+(15.012), (I-746)+(5.005)+(15.016), (I-746)+(5.005)+(15.025), (I-746)+(5.005)+(15.027), (I-746)+(5.005)+(15.047), (I-746)+(5.005)+(15.063), (I-746)+(5.005)+(15.064),

(I-746)+(5.008)+(9.002), (I-746)+(5.008)+(15.012), (I-746)+(5.008)+(15.016), (I-746)+(5.008)+(15.025), (I-746)+(5.008)+(15.027), (I-746)+(5.008)+(15.047), (I-746)+(5.008)+(15.063), (I-746)+(5.008)+(15.064),

(I-746)+(5.009)+(9.002), (I-746)+(5.009)+(15.012), (I-746)+(5.009)+(15.016), (I-746)+(5.009)+(15.025), (I-746)+(5.009)+(15.027), (I-746)+(5.009)+(15.047), (I-746)+(5.009)+(15.063), (I-746)+(5.009)+(15.064),

(I-746)+(5.011)+(9.002), (I-746)+(5.011)+(15.012), (I-746)+(5.011)+(15.016), (I-746)+(5.011)+(15.025), (I-746)+(5.011)+(15.027), (I-746)+(5.011)+(15.047), (I-746)+(5.011)+(15.063), (I-746)+(5.011)+(15.064),

(I-746)+(5.012)+(9.002), (I-746)+(5.012)+(15.012), (I-746)+(5.012)+(15.016), (I-746)+(5.012)+(15.025), (I-746)+(5.012)+(15.027), (I-746)+(5.012)+(15.047), (I-746)+(5.012)+(15.063), (I-746)+(5.012)+(15.064),

(I-746)+(5.013)+(9.002), (I-746)+(5.013)+(15.012), (I-746)+(5.013)+(15.016), (I-746)+(5.013)+(15.025), (I-746)+(5.013)+(15.027), (I-746)+(5.013)+(15.047), (I-746)+(5.013)+(15.063), (I-746)+(5.013)+(15.064),

(I-746)+(5.015)+(9.002), (I-746)+(5.015)+(15.012), (I-746)+(5.015)+(15.016), (I-746)+(5.015)+(15.025), (I-746)+(5.015)+(15.027), (I-746)+(5.015)+(15.047), (I-746)+(5.015)+(15.063), (I-746)+(5.015)+(15.064),

(I-746)+(5.018)+(9.002), (I-746)+(5.018)+(15.012), (I-746)+(5.018)+(15.016), (I-746)+(5.018)+(15.025), (I-746)+(5.018)+(15.027), (I-746)+(5.018)+(15.047), (I-746)+(5.018)+(15.063), (I-746)+(5.018)+(15.064),

(I-746)+(5.019)+(9.002), (I-746)+(5.019)+(15.012), (I-746)+(5.019)+(15.016), (I-746)+(5.019)+(15.025), (I-746)+(5.019)+(15.027), (I-746)+(5.019)+(15.047), (I-746)+(5.019)+(15.063), (I-746)+(5.019)+(15.064).

If two compounds (B) are present in the combinations according to the invention, more preferred compound combinations are selected from the group (G4-C1) consisting of the following mixtures:

(I-749)+(1.001)+(1.002), (I-749)+(1.001)+(1.003), (I-749)+(1.001)+(1.004), (I-749)+(1.001)+(1.005), (I-749)+(1.001)+(1.006), (I-749)+(1.001)+(1.007), (I-749)+(1.001)+(1.010), (I-749)+(1.001)+(1.011), (I-749)+(1.001)+(1.012), (I-749)+(1.001)+(1.013), (I-749)+(1.001)+(1.017), (I-749)+(1.001)+(1.018), (I-749)+(1.001)+(1.020), (I-749)+(1.001)+(1.021), (I-749)+(1.001)+(1.026), (I-749)+(1.001)+(1.027), (I-749)+(1.001)+(1.055), (I-749)+(1.001)+(1.059), (I-749)+(1.001)+(1.092), (I-749)+(1.001)+(2.001), (I-749)+(1.001)+(2.002), (I-749)+(1.001)+(2.003), (I-749)+(1.001)+(2.005), (I-749)+(1.001)+(2.007), (I-749)+(1.001)+(2.009), (I-749)+(1.001)+(2.010), (I-749)+(1.001)+(2.011), (I-749)+(1.001)+(2.012), (I-749)+(1.001)+(2.013), (I-749)+(1.001)+(2.014), (I-749)+(1.001)+(2.015), (I-749)+(1.001)+(2.016), (I-749)+(1.001)+(2.017), (I-749)+(1.001)+(2.018), (I-749)+(1.001)+(2.019), (I-749)+(1.001)+(2.021), (I-749)+(1.001)+(2.028), (I-749)+(1.001)+(2.030), (I-749)+(1.001)+(2.038), (I-749)+(1.001)+(3.003), (I-749)+(1.001)+(3.007), (I-749)+(1.001)+(3.012), (I-749)+(1.001)+(3.013), (I-749)+(1.001)+(3.016), (I-749)+(1.001)+(3.017), (I-749)+(1.001)+(3.020), (I-749)+(1.001)+(3.025), (I-749)+(1.001)+(3.026), (I-749)+(1.001)+(3.030), (I-749)+(1.001)+(3.031), (I-749)+(1.001)+(5.003), (I-749)+(1.001)+(5.004), (I-749)+(1.001)+(5.005), (I-749)+(1.001)+(5.008), (I-749)+(1.001)+(5.009), (I-749)+(1.001)+(5.011), (I-749)+(1.001)+(5.012), (I-749)+(1.001)+(5.013), (I-749)+(1.001)+(5.015), (I-749)+(1.001)+(5.018), (I-749)+(1.001)+(5.019), (I-749)+(1.001)+(6.002), (I-749)+(1.001)+(7.001), (I-749)+(1.001)+(7.005), (I-749)+(1.001)+(9.002), (I-749)+(1.001)+(9.004), (I-749)+(1.001)+(14.001), (I-749)+(1.001)+(14.002), (I-749)+(1.001)+(15.008), (I-749)+(1.001)+(15.011), (I-749)+(1.001)+(15.012), (I-749)+(1.001)+(15.016), (I-749)+(1.001)+(15.025), (I-749)+(1.001)+(15.027), (I-749)+(1.001)+(15.047), (I-749)+(1.001)+(15.063), (I-749)+(1.001)+(15.064), (I-749)+(1.001)+(16.001), (I-749)+(1.001)+(16.005), (I-749)+(1.001)+(17.001), (I-749)+(1.001)+(17.002), (I-749)+(1.001)+(17.003), (I-749)+(1.001)+(17.008), (I-749)+(1.001)+(18.001),

(I-749)+(1.002)+(1.001), (I-749)+(1.002)+(1.003), (I-749)+(1.002)+(1.004), (I-749)+(1.002)+(1.005), (I-749)+(1.002)+(1.006), (I-749)+(1.002)+(1.007), (I-749)+(1.002)+(1.010), (I-749)+(1.002)+(1.011), (I-749)+(1.002)+(1.012), (I-749)+(1.002)+(1.013), (I-749)+(1.002)+(1.017), (I-749)+(1.002)+(1.018), (I-749)+(1.002)+(1.020), (I-749)+(1.002)+(1.021), (I-749)+(1.002)+(1.026), (I-749)+(1.002)+(1.027), (I-749)+(1.002)+(1.055), (I-749)+(1.002)+(1.059), (I-749)+(1.002)+(1.092), (I-749)+(1.002)+(2.001), (I-749)+(1.002)+(2.002), (I-749)+(1.002)+(2.003), (I-749)+(1.002)+(2.005), (I-749)+(1.002)+(2.007), (I-749)+(1.002)+(2.009), (I-749)+(1.002)+(2.010), (I-749)+(1.002)+(2.011), (I-749)+(1.002)+(2.012), (I-749)+(1.002)+(2.013), (I-749)+(1.002)+(2.014), (I-749)+(1.002)+(2.015), (I-749)+(1.002)+(2.016), (I-749)+(1.002)+(2.017), (I-749)+(1.002)+(2.018), (I-749)+(1.002)+(2.019), (I-749)+(1.002)+(2.021), (I-749)+(1.002)+(2.028), (I-749)+(1.002)+(2.030), (I-749)+(1.002)+(2.038), (I-749)+(1.002)+(3.003), (I-749)+(1.002)+(3.007), (I-749)+(1.002)+(3.012), (I-749)+(1.002)+(3.013), (I-749)+(1.002)+(3.016), (I-749)+(1.002)+(3.017), (I-749)+(1.002)+(3.020), (I-749)+(1.002)+(3.025), (I-749)+(1.002)+(3.026), (I-749)+(1.002)+(3.030), (I-749)+(1.002)+(3.031), (I-749)+(1.002)+(5.003), (I-749)+(1.002)+(5.004), (I-749)+(1.002)+(5.005), (I-749)+(1.002)+(5.008), (I-749)+(1.002)+(5.009), (I-749)+(1.002)+(5.011), (I-749)+(1.002)+(5.012), (I-749)+(1.002)+(5.013), (I-749)+(1.002)+(5.015), (I-749)+(1.002)+(5.018), (I-749)+(1.002)+(5.019), (I-749)+(1.002)+(6.002), (I-749)+(1.002)+(7.001), (I-749)+(1.002)+(7.005), (I-749)+(1.002)+(9.002), (I-749)+(1.002)+(9.004), (I-749)+(1.002)+(14.001), (I-749)+(1.002)+(14.002), (I-749)+(1.002)+(15.008), (I-749)+(1.002)+(15.011), (I-749)+(1.002)+(15.012), (I-749)+(1.002)+(15.016), (I-749)+(1.002)+(15.025), (I-749)+(1.002)+(15.027), (I-749)+(1.002)+(15.047), (I-749)+(1.002)+(15.063), (I-749)+(1.002)+(15.064), (I-749)+(1.002)+(16.001), (I-749)+(1.002)+(16.005), (I-749)+(1.002)+(17.001), (I-749)+(1.002)+(17.002), (I-749)+(1.002)+(17.003), (I-749)+(1.002)+(17.008), (I-749)+(1.002)+(18.001),

(I-749)+(1.003)+(1.001), (I-749)+(1.003)+(1.002), (I-749)+(1.003)+(1.004), (I-749)+(1.003)+(1.005), (I-749)+(1.003)+(1.006), (I-749)+(1.003)+(1.007), (I-749)+(1.003)+(1.010), (I-749)+(1.003)+(1.011), (I-749)+(1.003)+(1.012), (I-749)+(1.003)+(1.013), (I-749)+(1.003)+(1.017), (I-749)+(1.003)+(1.018), (I-749)+(1.003)+(1.020), (I-749)+(1.003)+(1.021), (I-749)+(1.003)+(1.026), (I-749)+(1.003)+(1.027), (I-749)+(1.003)+(1.055), (I-749)+(1.003)+(1.059), (I-749)+(1.003)+(1.092), (I-749)+(1.003)+(2.001), (I-749)+(1.003)+(2.002), (I-749)+(1.003)+(2.003), (I-749)+(1.003)+(2.005), (I-749)+(1.003)+(2.007), (I-749)+(1.003)+(2.009), (I-749)+(1.003)+(2.010), (I-749)+(1.003)+(2.011), (I-749)+(1.003)+(2.012), (I-749)+(1.003)+(2.013), (I-749)+(1.003)+(2.014), (I-749)+(1.003)+(2.015), (I-749)+(1.003)+(2.016), (I-749)+(1.003)+(2.017), (I-749)+(1.003)+(2.018), (I-749)+(1.003)+(2.019), (I-749)+(1.003)+(2.021), (I-749)+(1.003)+(2.028), (I-749)+(1.003)+(2.030), (I-749)+(1.003)+(2.038), (I-749)+(1.003)+(3.003), (I-749)+(1.003)+(3.007), (I-749)+(1.003)+(3.012), (I-749)+(1.003)+(3.013), (I-749)+(1.003)+(3.016), (I-749)+(1.003)+(3.017), (I-749)+(1.003)+(3.020), (I-749)+(1.003)+(3.025), (I-749)+(1.003)+(3.026), (I-749)+(1.003)+(3.030), (I-749)+(1.003)+(3.031), (I-749)+(1.003)+(5.003), (I-749)+(1.003)+(5.004), (I-749)+(1.003)+(5.005), (I-749)+(1.003)+(5.008), (I-749)+(1.003)+(5.009), (I-749)+(1.003)+(5.011), (I-749)+(1.003)+(5.012), (I-749)+(1.003)+(5.013), (I-749)+(1.003)+(5.015), (I-749)+(1.003)+(5.018), (I-749)+(1.003)+(5.019), (I-749)+(1.003)+(6.002), (I-749)+(1.003)+(7.001), (I-749)+(1.003)+(7.005), (I-749)+(1.003)+(9.002), (I-749)+(1.003)+(9.004), (I-749)+(1.003)+(14.001), (I-749)+(1.003)+(14.002), (I-749)+(1.003)+(15.008), (I-749)+(1.003)+(15.011), (I-749)+(1.003)+(15.012), (I-749)+(1.003)+(15.016), (I-749)+(1.003)+(15.025), (I-749)+(1.003)+(15.027), (I-749)+(1.003)+(15.047), (I-749)+(1.003)+(15.063), (I-749)+(1.003)+(15.064), (I-749)+(1.003)+(16.001), (I-749)+(1.003)+(16.005), (I-749)+(1.003)+(17.001), (I-749)+(1.003)+(17.002), (I-749)+(1.003)+(17.003), (I-749)+(1.003)+(17.008), (I-749)+(1.003)+(18.001),

(I-749)+(1.004)+(1.001), (I-749)+(1.004)+(1.002), (I-749)+(1.004)+(1.003), (I-749)+(1.004)+(1.005), (I-749)+(1.004)+(1.006), (I-749)+(1.004)+(1.007), (I-749)+(1.004)+(1.010), (I-749)+(1.004)+(1.011), (I-749)+(1.004)+(1.012), (I-749)+(1.004)+(1.013), (I-749)+(1.004)+(1.017), (I-749)+(1.004)+(1.018), (I-749)+(1.004)+(1.020), (I-749)+(1.004)+(1.021), (I-749)+(1.004)+(1.026), (I-749)+(1.004)+(1.027), (I-749)+(1.004)+(1.055), (I-749)+(1.004)+(1.059), (I-749)+(1.004)+(1.092), (I-749)+(1.004)+(2.001), (I-749)+(1.004)+(2.002), (I-749)+(1.004)+(2.003), (I-749)+(1.004)+(2.005), (I-749)+(1.004)+(2.007), (I-749)+(1.004)+(2.009), (I-749)+(1.004)+(2.010), (I-749)+(1.004)+(2.011), (I-749)+(1.004)+(2.012), (I-749)+(1.004)+(2.013), (I-749)+(1.004)+(2.014), (I-749)+(1.004)+(2.015), (I-749)+(1.004)+(2.016), (I-749)+(1.004)+(2.017), (I-749)+(1.004)+(2.018), (I-749)+(1.004)+(2.019), (I-749)+(1.004)+(2.021), (I-749)+(1.004)+(2.028), (I-749)+(1.004)+(2.030), (I-749)+(1.004)+(2.038), (I-749)+(1.004)+(3.003), (I-749)+(1.004)+(3.007), (I-749)+(1.004)+(3.012), (I-749)+(1.004)+(3.013), (I-749)+(1.004)+(3.016), (I-749)+(1.004)+(3.017), (I-749)+(1.004)+(3.020), (I-749)+(1.004)+(3.025), (I-749)+(1.004)+(3.026), (I-749)+(1.004)+(3.030), (I-749)+(1.004)+(3.031), (I-749)+(1.004)+(5.003), (I-749)+(1.004)+(5.004), (I-749)+(1.004)+(5.005), (I-749)+(1.004)+(5.008), (I-749)+(1.004)+(5.009), (I-749)+(1.004)+(5.011), (I-749)+(1.004)+(5.012), (I-749)+(1.004)+(5.013), (I-749)+(1.004)+(5.015), (I-749)+(1.004)+(5.018), (I-749)+(1.004)+(5.019), (I-749)+(1.004)+(6.002), (I-749)+(1.004)+(7.001), (I-749)+(1.004)+(7.005), (I-749)+(1.004)+(9.002), (I-749)+(1.004)+(9.004), (I-749)+(1.004)+(14.001), (I-749)+(1.004)+(14.002), (I-749)+(1.004)+(15.008), (I-749)+(1.004)+(15.011), (I-749)+(1.004)+(15.012), (I-749)+(1.004)+(15.016), (I-749)+(1.004)+(15.025), (I-749)+(1.004)+(15.027), (I-749)+(1.004)+(15.047), (I-749)+(1.004)+(15.063), (I-749)+(1.004)+(15.064), (I-749)+(1.004)+(16.001), (I-749)+(1.004)+(16.005), (I-749)+(1.004)+(17.001), (I-749)+(1.004)+(17.002), (I-749)+(1.004)+(17.003), (I-749)+(1.004)+(17.008), (I-749)+(1.004)+(18.001),

(I-749)+(1.005)+(1.001), (I-749)+(1.005)+(1.002), (I-749)+(1.005)+(1.003), (I-749)+(1.005)+(1.004), (I-749)+(1.005)+(1.006), (I-749)+(1.005)+(1.007), (I-749)+(1.005)+(1.010), (I-749)+(1.005)+(1.011), (I-749)+(1.005)+(1.012), (I-749)+(1.005)+(1.013), (I-749)+(1.005)+(1.017), (I-749)+(1.005)+(1.018), (I-749)+(1.005)+(1.020), (I-749)+(1.005)+(1.021), (I-749)+(1.005)+(1.026), (I-749)+(1.005)+(1.027), (I-749)+(1.005)+(1.055), (I-749)+(1.005)+(1.059), (I-749)+(1.005)+(1.092), (I-749)+(1.005)+(2.001), (I-749)+(1.005)+(2.002), (I-749)+(1.005)+(2.003), (I-749)+(1.005)+(2.005), (I-749)+(1.005)+(2.007), (I-749)+(1.005)+(2.009), (I-749)+(1.005)+(2.010), (I-749)+(1.005)+(2.011), (I-749)+(1.005)+(2.012), (I-749)+(1.005)+(2.013), (I-749)+(1.005)+(2.014), (I-749)+(1.005)+(2.015), (I-749)+(1.005)+(2.016), (I-749)+(1.005)+(2.017), (I-749)+(1.005)+(2.018), (I-749)+(1.005)+(2.019), (I-749)+(1.005)+(2.021), (I-749)+(1.005)+(2.028), (I-749)+(1.005)+(2.030), (I-749)+(1.005)+(2.038), (I-749)+(1.005)+(3.003), (I-749)+(1.005)+(3.007), (I-749)+(1.005)+(3.012), (I-749)+(1.005)+(3.013), (I-749)+(1.005)+(3.016), (I-749)+(1.005)+(3.017), (I-749)+(1.005)+(3.020), (I-749)+(1.005)+(3.025), (I-749)+(1.005)+(3.026), (I-749)+(1.005)+(3.030), (I-749)+(1.005)+(3.031), (I-749)+(1.005)+(5.003), (I-749)+(1.005)+(5.004), (I-749)+(1.005)+(5.005), (I-749)+(1.005)+(5.008), (I-749)+(1.005)+(5.009), (I-749)+(1.005)+(5.011), (I-749)+(1.005)+(5.012), (I-749)+(1.005)+(5.013), (I-749)+(1.005)+(5.015), (I-749)+(1.005)+(5.018), (I-749)+(1.005)+(5.019), (I-749)+(1.005)+(6.002), (I-749)+(1.005)+(7.001), (I-749)+(1.005)+(7.005), (I-749)+(1.005)+(9.002), (I-749)+(1.005)+(9.004), (I-749)+(1.005)+(14.001), (I-749)+(1.005)+(14.002), (I-749)+(1.005)+(15.008), (I-749)+(1.005)+(15.011), (I-749)+(1.005)+(15.012), (I-749)+(1.005)+(15.016), (I-749)+(1.005)+(15.025), (I-749)+(1.005)+(15.027), (I-749)+(1.005)+(15.047), (I-749)+(1.005)+(15.063), (I-749)+(1.005)+(15.064), (I-749)+(1.005)+(16.001), (I-749)+(1.005)+(16.005), (I-749)+(1.005)+(17.001), (I-749)+(1.005)+(17.002), (I-749)+(1.005)+(17.003), (I-749)+(1.005)+(17.008), (I-749)+(1.005)+(18.001),

(I-749)+(1.006)+(1.001), (I-749)+(1.006)+(1.002), (I-749)+(1.006)+(1.003), (I-749)+(1.006)+(1.004), (I-749)+(1.006)+(1.005), (I-749)+(1.006)+(1.007), (I-749)+(1.006)+(1.010), (I-749)+(1.006)+(1.011), (I-749)+(1.006)+(1.012), (I-749)+(1.006)+(1.013), (I-749)+(1.006)+(1.017), (I-749)+(1.006)+(1.018), (I-749)+(1.006)+(1.020), (I-749)+(1.006)+(1.021), (I-749)+(1.006)+(1.026), (I-749)+(1.006)+(1.027), (I-749)+(1.006)+(1.055), (I-749)+(1.006)+(1.059), (I-749)+(1.006)+(1.092), (I-749)+(1.006)+(2.001), (I-749)+(1.006)+(2.002), (I-749)+(1.006)+(2.003), (I-749)+(1.006)+(2.005), (I-749)+(1.006)+(2.007), (I-749)+(1.006)+(2.009), (I-749)+(1.006)+(2.010), (I-749)+(1.006)+(2.011), (I-749)+(1.006)+(2.012), (I-749)+(1.006)+(2.013), (I-749)+(1.006)+(2.014), (I-749)+(1.006)+(2.015), (I-749)+(1.006)+(2.016), (I-749)+(1.006)+(2.017), (I-749)+(1.006)+(2.018), (I-749)+(1.006)+(2.019), (I-749)+(1.006)+(2.021), (I-749)+(1.006)+(2.028), (I-749)+(1.006)+(2.030), (I-749)+(1.006)+(2.038), (I-749)+(1.006)+(3.003), (I-749)+(1.006)+(3.007), (I-749)+(1.006)+(3.012), (I-749)+(1.006)+(3.013), (I-749)+(1.006)+(3.016), (I-749)+(1.006)+(3.017), (I-749)+(1.006)+(3.020), (I-749)+(1.006)+(3.025), (I-749)+(1.006)+(3.026), (I-749)+(1.006)+(3.030), (I-749)+(1.006)+(3.031), (I-749)+(1.006)+(5.003), (I-749)+(1.006)+(5.004), (I-749)+(1.006)+(5.005), (I-749)+(1.006)+(5.008), (I-749)+(1.006)+(5.009), (I-749)+(1.006)+(5.011), (I-749)+(1.006)+(5.012), (I-749)+(1.006)+(5.013), (I-749)+(1.006)+(5.015), (I-749)+(1.006)+(5.018), (I-749)+(1.006)+(5.019), (I-749)+(1.006)+(6.002), (I-749)+(1.006)+(7.001), (I-749)+(1.006)+(7.005), (I-749)+(1.006)+(9.002), (I-749)+(1.006)+(9.004), (I-749)+(1.006)+(14.001), (I-749)+(1.006)+(14.002), (I-749)+(1.006)+(15.008), (I-749)+(1.006)+(15.011), (I-749)+(1.006)+(15.012), (I-749)+(1.006)+(15.016), (I-749)+(1.006)+(15.025), (I-749)+(1.006)+(15.027), (I-749)+(1.006)+(15.047), (I-749)+(1.006)+(15.063), (I-749)+(1.006)+(15.064), (I-749)+(1.006)+(16.001), (I-749)+(1.006)+(16.005), (I-749)+(1.006)+(17.001), (I-749)+(1.006)+(17.002), (I-749)+(1.006)+(17.003), (I-749)+(1.006)+(17.008), (I-749)+(1.006)+(18.001),

(I-749)+(1.007)+(1.001), (I-749)+(1.007)+(1.002), (I-749)+(1.007)+(1.003), (I-749)+(1.007)+(1.004), (I-749)+(1.007)+(1.005), (I-749)+(1.007)+(1.006), (I-749)+(1.007)+(1.010), (I-749)+(1.007)+(1.011), (I-749)+(1.007)+(1.012), (I-749)+(1.007)+(1.013), (I-749)+(1.007)+(1.017), (I-749)+(1.007)+(1.018), (I-749)+(1.007)+(1.020), (I-749)+(1.007)+(1.021), (I-749)+(1.007)+(1.026), (I-749)+(1.007)+(1.027), (I-749)+(1.007)+(1.055), (I-749)+(1.007)+(1.059), (I-749)+(1.007)+(1.092), (I-749)+(1.007)+(2.001), (I-749)+(1.007)+(2.002), (I-749)+(1.007)+(2.003), (I-749)+(1.007)+(2.005), (I-749)+(1.007)+(2.007), (I-749)+(1.007)+(2.009), (I-749)+(1.007)+(2.010), (I-749)+(1.007)+(2.011), (I-749)+(1.007)+(2.012), (I-749)+(1.007)+(2.013), (I-749)+(1.007)+(2.014), (I-749)+(1.007)+(2.015), (I-749)+(1.007)+(2.016), (I-749)+(1.007)+(2.017), (I-749)+(1.007)+(2.018), (I-749)+(1.007)+(2.019), (I-749)+(1.007)+(2.021), (I-749)+(1.007)+(2.028), (I-749)+(1.007)+(2.030), (I-749)+(1.007)+(2.038), (I-749)+(1.007)+(3.003), (I-749)+(1.007)+(3.007), (I-749)+(1.007)+(3.012), (I-749)+(1.007)+(3.013), (I-749)+(1.007)+(3.016), (I-749)+(1.007)+(3.017), (I-749)+(1.007)+(3.020), (I-749)+(1.007)+(3.025), (I-749)+(1.007)+(3.026), (I-749)+(1.007)+(3.030), (I-749)+(1.007)+(3.031), (I-749)+(1.007)+(5.003), (I-749)+(1.007)+(5.004), (I-749)+(1.007)+(5.005), (I-749)+(1.007)+(5.008), (I-749)+(1.007)+(5.009), (I-749)+(1.007)+(5.011), (I-749)+(1.007)+(5.012), (I-749)+(1.007)+(5.013), (I-749)+(1.007)+(5.015), (I-749)+(1.007)+(5.018), (I-749)+(1.007)+(5.019), (I-749)+(1.007)+(6.002), (I-749)+(1.007)+(7.001), (I-749)+(1.007)+(7.005), (I-749)+(1.007)+(9.002), (I-749)+(1.007)+(9.004), (I-749)+(1.007)+(14.001), (I-749)+(1.007)+(14.002), (I-749)+(1.007)+(15.008), (I-749)+(1.007)+(15.011), (I-749)+(1.007)+(15.012), (I-749)+(1.007)+(15.016), (I-749)+(1.007)+(15.025), (I-749)+(1.007)+(15.027), (I-749)+(1.007)+(15.047), (I-749)+(1.007)+(15.063), (I-749)+(1.007)+(15.064), (I-749)+(1.007)+(16.001), (I-749)+(1.007)+(16.005), (I-749)+(1.007)+(17.001), (I-749)+(1.007)+(17.002), (I-749)+(1.007)+(17.003), (I-749)+(1.007)+(17.008), (I-749)+(1.007)+(18.001),

(I-749)+(1.010)+(1.001), (I-749)+(1.010)+(1.002), (I-749)+(1.010)+(1.003), (I-749)+(1.010)+(1.004), (I-749)+(1.010)+(1.005), (I-749)+(1.010)+(1.006), (I-749)+(1.010)+(1.007), (I-749)+(1.010)+(1.011), (I-749)+(1.010)+(1.012), (I-749)+(1.010)+(1.013), (I-749)+(1.010)+(1.017), (I-749)+(1.010)+(1.018), (I-749)+(1.010)+(1.020), (I-749)+(1.010)+(1.021), (I-749)+(1.010)+(1.026), (I-749)+(1.010)+(1.027), (I-749)+(1.010)+(1.055), (I-749)+(1.010)+(1.059), (I-749)+(1.010)+(1.092), (I-749)+(1.010)+(2.001), (I-749)+(1.010)+(2.002), (I-749)+(1.010)+(2.003), (I-749)+(1.010)+(2.005), (I-749)+(1.010)+(2.007), (I-749)+(1.010)+(2.009), (I-749)+(1.010)+(2.010), (I-749)+(1.010)+(2.011), (I-749)+(1.010)+(2.012), (I-749)+(1.010)+(2.013), (I-749)+(1.010)+(2.014), (I-749)+(1.010)+(2.015), (I-749)+(1.010)+(2.016), (I-749)+(1.010)+(2.017), (I-749)+(1.010)+(2.018), (I-749)+(1.010)+(2.019), (I-749)+(1.010)+(2.021), (I-749)+(1.010)+(2.028), (I-749)+(1.010)+(2.030), (I-749)+(1.010)+(2.038), (I-749)+(1.010)+(3.003), (I-749)+(1.010)+(3.007), (I-749)+(1.010)+(3.012), (I-749)+(1.010)+(3.013), (I-749)+(1.010)+(3.016), (I-749)+(1.010)+(3.017), (I-749)+(1.010)+(3.020), (I-749)+(1.010)+(3.025), (I-749)+(1.010)+(3.026), (I-749)+(1.010)+(3.030), (I-749)+(1.010)+(3.031), (I-749)+(1.010)+(5.003), (I-749)+(1.010)+(5.004), (I-749)+(1.010)+(5.005), (I-749)+(1.010)+(5.008), (I-749)+(1.010)+(5.009), (I-749)+(1.010)+(5.011), (I-749)+(1.010)+(5.012), (I-749)+(1.010)+(5.013), (I-749)+(1.010)+(5.015), (I-749)+(1.010)+(5.018), (I-749)+(1.010)+(5.019), (I-749)+(1.010)+(6.002), (I-749)+(1.010)+(7.001), (I-749)+(1.010)+(7.005), (I-749)+(1.010)+(9.002), (I-749)+(1.010)+(9.004), (I-749)+(1.010)+(14.001), (I-749)+(1.010)+(14.002), (I-749)+(1.010)+(15.008), (I-749)+(1.010)+(15.011), (I-749)+(1.010)+(15.012), (I-749)+(1.010)+(15.016), (I-749)+(1.010)+(15.025), (I-749)+(1.010)+(15.027), (I-749)+(1.010)+(15.047), (I-749)+(1.010)+(15.063), (I-749)+(1.010)+(15.064), (I-749)+(1.010)+(16.001), (I-749)+(1.010)+(16.005), (I-749)+(1.010)+(17.001), (I-749)+(1.010)+(17.002), (I-749)+(1.010)+(17.003), (I-749)+(1.010)+(17.008), (I-749)+(1.010)+(18.001),

(I-749)+(1.011)+(1.001), (I-749)+(1.011)+(1.002), (I-749)+(1.011)+(1.003), (I-749)+(1.011)+(1.004), (I-749)+(1.011)+(1.005), (I-749)+(1.011)+(1.006), (I-749)+(1.011)+(1.007), (I-749)+(1.011)+(1.010), (I-749)+(1.011)+(1.012), (I-749)+(1.011)+(1.013), (I-749)+(1.011)+(1.017), (I-749)+(1.011)+(1.018), (I-749)+(1.011)+(1.020), (I-749)+(1.011)+(1.021), (I-749)+(1.011)+(1.026), (I-749)+(1.011)+(1.027), (I-749)+(1.011)+(1.055), (I-749)+(1.011)+(1.059), (I-749)+(1.011)+(1.092), (I-749)+(1.011)+(2.001), (I-749)+(1.011)+(2.002), (I-749)+(1.011)+(2.003), (I-749)+(1.011)+(2.005), (I-749)+(1.011)+(2.007), (I-749)+(1.011)+(2.009), (I-749)+(1.011)+(2.010), (I-749)+(1.011)+(2.011), (I-749)+(1.011)+(2.012), (I-749)+(1.011)+(2.013), (I-749)+(1.011)+(2.014), (I-749)+(1.011)+(2.015), (I-749)+(1.011)+(2.016), (I-749)+(1.011)+(2.017), (I-749)+(1.011)+(2.018), (I-749)+(1.011)+(2.019), (I-749)+(1.011)+(2.021), (I-749)+(1.011)+(2.028), (I-749)+(1.011)+(2.030), (I-749)+(1.011)+(2.038), (I-749)+(1.011)+(3.003), (I-749)+(1.011)+(3.007), (I-749)+(1.011)+(3.012), (I-749)+(1.011)+(3.013), (I-749)+(1.011)+(3.016), (I-749)+(1.011)+(3.017), (I-749)+(1.011)+(3.020), (I-749)+(1.011)+(3.025), (I-749)+(1.011)+(3.026), (I-749)+(1.011)+(3.030), (I-749)+(1.011)+(3.031), (I-749)+(1.011)+(5.003), (I-749)+(1.011)+(5.004), (I-749)+(1.011)+(5.005), (I-749)+(1.011)+(5.008), (I-749)+(1.011)+(5.009), (I-749)+(1.011)+(5.011), (I-749)+(1.011)+(5.012), (I-749)+(1.011)+(5.013), (I-749)+(1.011)+(5.015), (I-749)+(1.011)+(5.018), (I-749)+(1.011)+(5.019), (I-749)+(1.011)+(6.002), (I-749)+(1.011)+(7.001), (I-749)+(1.011)+(7.005), (I-749)+(1.011)+(9.002), (I-749)+(1.011)+(9.004), (I-749)+(1.011)+(14.001), (I-749)+(1.011)+(14.002), (I-749)+(1.011)+(15.008), (I-749)+(1.011)+(15.011), (I-749)+(1.011)+(15.012), (I-749)+(1.011)+(15.016), (I-749)+(1.011)+(15.025), (I-749)+(1.011)+(15.027), (I-749)+(1.011)+(15.047), (I-749)+(1.011)+(15.063), (I-749)+(1.011)+(15.064), (I-749)+(1.011)+(16.001), (I-749)+(1.011)+(16.005), (I-749)+(1.011)+(17.001), (I-749)+(1.011)+(17.002), (I-749)+(1.011)+(17.003), (I-749)+(1.011)+(17.008), (I-749)+(1.011)+(18.001),

(I-749)+(1.012)+(1.001), (I-749)+(1.012)+(1.002), (I-749)+(1.012)+(1.003), (I-749)+(1.012)+(1.004), (I-749)+(1.012)+(1.005), (I-749)+(1.012)+(1.006), (I-749)+(1.012)+(1.007), (I-749)+(1.012)+(1.010), (I-749)+(1.012)+(1.011), (I-749)+(1.012)+(1.013), (I-749)+(1.012)+(1.017), (I-749)+(1.012)+(1.018), (I-749)+(1.012)+(1.020), (I-749)+(1.012)+(1.021), (I-749)+(1.012)+(1.026), (I-749)+(1.012)+(1.027), (I-749)+(1.012)+(1.055), (I-749)+(1.012)+(1.059), (I-749)+(1.012)+(1.092), (I-749)+(1.012)+(2.001), (I-749)+(1.012)+(2.002), (I-749)+(1.012)+(2.003), (I-749)+(1.012)+(2.005), (I-749)+(1.012)+(2.007), (I-749)+(1.012)+(2.009), (I-749)+(1.012)+(2.010), (I-749)+(1.012)+(2.011), (I-749)+(1.012)+(2.012), (I-749)+(1.012)+(2.013), (I-749)+(1.012)+(2.014), (I-749)+(1.012)+(2.015), (I-749)+(1.012)+(2.016), (I-749)+(1.012)+(2.017), (I-749)+(1.012)+(2.018), (I-749)+(1.012)+(2.019), (I-749)+(1.012)+(2.021), (I-749)+(1.012)+(2.028), (I-749)+(1.012)+(2.030), (I-749)+(1.012)+(2.038), (I-749)+(1.012)+(3.003), (I-749)+(1.012)+(3.007), (I-749)+(1.012)+(3.012), (I-749)+(1.012)+(3.013), (I-749)+(1.012)+(3.016), (I-749)+(1.012)+(3.017), (I-749)+(1.012)+(3.020), (I-749)+(1.012)+(3.025), (I-749)+(1.012)+(3.026), (I-749)+(1.012)+(3.030), (I-749)+(1.012)+(3.031), (I-749)+(1.012)+(5.003), (I-749)+(1.012)+(5.004), (I-749)+(1.012)+(5.005), (I-749)+(1.012)+(5.008), (I-749)+(1.012)+(5.009), (I-749)+(1.012)+(5.011), (I-749)+(1.012)+(5.012), (I-749)+(1.012)+(5.013), (I-749)+(1.012)+(5.015), (I-749)+(1.012)+(5.018), (I-749)+(1.012)+(5.019), (I-749)+(1.012)+(6.002), (I-749)+(1.012)+(7.001), (I-749)+(1.012)+(7.005), (I-749)+(1.012)+(9.002), (I-749)+(1.012)+(9.004), (I-749)+(1.012)+(14.001), (I-749)+(1.012)+(14.002), (I-749)+(1.012)+(15.008), (I-749)+(1.012)+(15.011), (I-749)+(1.012)+(15.012), (I-749)+(1.012)+(15.016), (I-749)+(1.012)+(15.025), (I-749)+(1.012)+(15.027), (I-749)+(1.012)+(15.047), (I-749)+(1.012)+(15.063), (I-749)+(1.012)+(15.064), (I-749)+(1.012)+(16.001), (I-749)+(1.012)+(16.005), (I-749)+(1.012)+(17.001), (I-749)+(1.012)+(17.002), (I-749)+(1.012)+(17.003), (I-749)+(1.012)+(17.008), (I-749)+(1.012)+(18.001),

(I-749)+(1.013)+(1.001), (I-749)+(1.013)+(1.002), (I-749)+(1.013)+(1.003), (I-749)+(1.013)+(1.004), (I-749)+(1.013)+(1.005), (I-749)+(1.013)+(1.006), (I-749)+(1.013)+(1.007), (I-749)+(1.013)+(1.010), (I-749)+(1.013)+(1.011), (I-749)+(1.013)+(1.012), (I-749)+(1.013)+(1.017), (I-749)+(1.013)+(1.018), (I-749)+(1.013)+(1.020), (I-749)+(1.013)+(1.021), (I-749)+(1.013)+(1.026), (I-749)+(1.013)+(1.027), (I-749)+(1.013)+(1.055), (I-749)+(1.013)+(1.059), (I-749)+(1.013)+(1.092), (I-749)+(1.013)+(2.001), (I-749)+(1.013)+(2.002), (I-749)+(1.013)+(2.003), (I-749)+(1.013)+(2.005), (I-749)+(1.013)+(2.007), (I-749)+(1.013)+(2.009), (I-749)+(1.013)+(2.010), (I-749)+(1.013)+(2.011), (I-749)+(1.013)+(2.012), (I-749)+(1.013)+(2.013), (I-749)+(1.013)+(2.014), (I-749)+(1.013)+(2.015), (I-749)+(1.013)+(2.016), (I-749)+(1.013)+(2.017), (I-749)+(1.013)+(2.018), (I-749)+(1.013)+(2.019), (I-749)+(1.013)+(2.021), (I-749)+(1.013)+(2.028), (I-749)+(1.013)+(2.030), (I-749)+(1.013)+(2.038), (I-749)+(1.013)+(3.003), (I-749)+(1.013)+(3.007), (I-749)+(1.013)+(3.012), (I-749)+(1.013)+(3.013), (I-749)+(1.013)+(3.016), (I-749)+(1.013)+(3.017), (I-749)+(1.013)+(3.020), (I-749)+(1.013)+(3.025), (I-749)+(1.013)+(3.026), (I-749)+(1.013)+(3.030), (I-749)+(1.013)+(3.031), (I-749)+(1.013)+(5.003), (I-749)+(1.013)+(5.004), (I-749)+(1.013)+(5.005), (I-749)+(1.013)+(5.008), (I-749)+(1.013)+(5.009), (I-749)+(1.013)+(5.011), (I-749)+(1.013)+(5.012), (I-749)+(1.013)+(5.013), (I-749)+(1.013)+(5.015), (I-749)+(1.013)+(5.018), (I-749)+(1.013)+(5.019), (I-749)+(1.013)+(6.002), (I-749)+(1.013)+(7.001), (I-749)+(1.013)+(7.005), (I-749)+(1.013)+(9.002), (I-749)+(1.013)+(9.004), (I-749)+(1.013)+(14.001), (I-749)+(1.013)+(14.002), (I-749)+(1.013)+(15.008), (I-749)+(1.013)+(15.011), (I-749)+(1.013)+(15.012), (I-749)+(1.013)+(15.016), (I-749)+(1.013)+(15.025), (I-749)+(1.013)+(15.027), (I-749)+(1.013)+(15.047), (I-749)+(1.013)+(15.063), (I-749)+(1.013)+(15.064), (I-749)+(1.013)+(16.001), (I-749)+(1.013)+(16.005), (I-749)+(1.013)+(17.001), (I-749)+(1.013)+(17.002), (I-749)+(1.013)+(17.003), (I-749)+(1.013)+(17.008), (I-749)+(1.013)+(18.001),

(I-749)+(1.017)+(1.001), (I-749)+(1.017)+(1.002), (I-749)+(1.017)+(1.003), (I-749)+(1.017)+(1.004), (I-749)+(1.017)+(1.005), (I-749)+(1.017)+(1.006), (I-749)+(1.017)+(1.007), (I-749)+(1.017)+(1.010), (I-749)+(1.017)+(1.011), (I-749)+(1.017)+(1.012), (I-749)+(1.017)+(1.013), (I-749)+(1.017)+(1.018), (I-749)+(1.017)+(1.020), (I-749)+(1.017)+(1.021), (I-749)+(1.017)+(1.026), (I-749)+(1.017)+(1.027), (I-749)+(1.017)+(1.055), (I-749)+(1.017)+(1.059), (I-749)+(1.017)+(1.092), (I-749)+(1.017)+(2.001), (I-749)+(1.017)+(2.002), (I-749)+(1.017)+(2.003), (I-749)+(1.017)+(2.005), (I-749)+(1.017)+(2.007), (I-749)+(1.017)+(2.009), (I-749)+(1.017)+(2.010), (I-749)+(1.017)+(2.011), (I-749)+(1.017)+(2.012), (I-749)+(1.017)+(2.013), (I-749)+(1.017)+(2.014), (I-749)+(1.017)+(2.015), (I-749)+(1.017)+(2.016), (I-749)+(1.017)+(2.017), (I-749)+(1.017)+(2.018), (I-749)+(1.017)+(2.019), (I-749)+(1.017)+(2.021), (I-749)+(1.017)+(2.028), (I-749)+(1.017)+(2.030), (I-749)+(1.017)+(2.038), (I-749)+(1.017)+(3.003), (I-749)+(1.017)+(3.007), (I-749)+(1.017)+(3.012), (I-749)+(1.017)+(3.013), (I-749)+(1.017)+(3.016), (I-749)+(1.017)+(3.017), (I-749)+(1.017)+(3.020), (I-749)+(1.017)+(3.025), (I-749)+(1.017)+(3.026), (I-749)+(1.017)+(3.030), (I-749)+(1.017)+(3.031), (I-749)+(1.017)+(5.003), (I-749)+(1.017)+(5.004), (I-749)+(1.017)+(5.005), (I-749)+(1.017)+(5.008), (I-749)+(1.017)+(5.009), (I-749)+(1.017)+(5.011), (I-749)+(1.017)+(5.012), (I-749)+(1.017)+(5.013), (I-749)+(1.017)+(5.015), (I-749)+(1.017)+(5.018), (I-749)+(1.017)+(5.019), (I-749)+(1.017)+(6.002), (I-749)+(1.017)+(7.001), (I-749)+(1.017)+(7.005), (I-749)+(1.017)+(9.002), (I-749)+(1.017)+(9.004), (I-749)+(1.017)+(14.001), (I-749)+(1.017)+(14.002), (I-749)+(1.017)+(15.008), (I-749)+(1.017)+(15.011), (I-749)+(1.017)+(15.012), (I-749)+(1.017)+(15.016), (I-749)+(1.017)+(15.025), (I-749)+(1.017)+(15.027), (I-749)+(1.017)+(15.047), (I-749)+(1.017)+(15.063), (I-749)+(1.017)+(15.064), (I-749)+(1.017)+(16.001), (I-749)+(1.017)+(16.005), (I-749)+(1.017)+(17.001), (I-749)+(1.017)+(17.002), (I-749)+(1.017)+(17.003), (I-749)+(1.017)+(17.008), (I-749)+(1.017)+(18.001),

(I-749)+(1.018)+(1.001), (I-749)+(1.018)+(1.002), (I-749)+(1.018)+(1.003), (I-749)+(1.018)+(1.004), (I-749)+(1.018)+(1.005), (I-749)+(1.018)+(1.006), (I-749)+(1.018)+(1.007), (I-749)+(1.018)+(1.010), (I-749)+(1.018)+(1.011), (I-749)+(1.018)+(1.012), (I-749)+(1.018)+(1.013), (I-749)+(1.018)+(1.017), (I-749)+(1.018)+(1.020), (I-749)+(1.018)+(1.021), (I-749)+(1.018)+(1.026), (I-749)+(1.018)+(1.027), (I-749)+(1.018)+(1.055), (I-749)+(1.018)+(1.059), (I-749)+(1.018)+(1.092), (I-749)+(1.018)+(2.001), (I-749)+(1.018)+(2.002), (I-749)+(1.018)+(2.003), (I-749)+(1.018)+(2.005), (I-749)+(1.018)+(2.007), (I-749)+(1.018)+(2.009), (I-749)+(1.018)+(2.010), (I-749)+(1.018)+(2.011), (I-749)+(1.018)+(2.012), (I-749)+(1.018)+(2.013), (I-749)+(1.018)+(2.014), (I-749)+(1.018)+(2.015), (I-749)+(1.018)+(2.016), (I-749)+(1.018)+(2.017), (I-749)+(1.018)+(2.018), (I-749)+(1.018)+(2.019), (I-749)+(1.018)+(2.021), (I-749)+(1.018)+(2.028), (I-749)+(1.018)+(2.030), (I-749)+(1.018)+(2.038), (I-749)+(1.018)+(3.003), (I-749)+(1.018)+(3.007), (I-749)+(1.018)+(3.012), (I-749)+(1.018)+(3.013), (I-749)+(1.018)+(3.016), (I-749)+(1.018)+(3.017), (I-749)+(1.018)+(3.020), (I-749)+(1.018)+(3.025), (I-749)+(1.018)+(3.026), (I-749)+(1.018)+(3.030), (I-749)+(1.018)+(3.031), (I-749)+(1.018)+(5.003), (I-749)+(1.018)+(5.004), (I-749)+(1.018)+(5.005), (I-749)+(1.018)+(5.008), (I-749)+(1.018)+(5.009), (I-749)+(1.018)+(5.011), (I-749)+(1.018)+(5.012), (I-749)+(1.018)+(5.013), (I-749)+(1.018)+(5.015), (I-749)+(1.018)+(5.018), (I-749)+(1.018)+(5.019), (I-749)+(1.018)+(6.002), (I-749)+(1.018)+(7.001), (I-749)+(1.018)+(7.005), (I-749)+(1.018)+(9.002), (I-749)+(1.018)+(9.004), (I-749)+(1.018)+(14.001), (I-749)+(1.018)+(14.002), (I-749)+(1.018)+(15.008), (I-749)+(1.018)+(15.011), (I-749)+(1.018)+(15.012), (I-749)+(1.018)+(15.016), (I-749)+(1.018)+(15.025), (I-749)+(1.018)+(15.027), (I-749)+(1.018)+(15.047), (I-749)+(1.018)+(15.063), (I-749)+(1.018)+(15.064), (I-749)+(1.018)+(16.001), (I-749)+(1.018)+(16.005), (I-749)+(1.018)+(17.001), (I-749)+(1.018)+(17.002), (I-749)+(1.018)+(17.003), (I-749)+(1.018)+(17.008), (I-749)+(1.018)+(18.001),

(I-749)+(1.020)+(1.001), (I-749)+(1.020)+(1.002), (I-749)+(1.020)+(1.003), (I-749)+(1.020)+(1.004), (I-749)+(1.020)+(1.005), (I-749)+(1.020)+(1.006), (I-749)+(1.020)+(1.007), (I-749)+(1.020)+(1.010), (I-749)+(1.020)+(1.011), (I-749)+(1.020)+(1.012), (I-749)+(1.020)+(1.013), (I-749)+(1.020)+(1.017), (I-749)+(1.020)+(1.018), (I-749)+(1.020)+(1.021), (I-749)+(1.020)+(1.026), (I-749)+(1.020)+(1.027), (I-749)+(1.020)+(1.055), (I-749)+(1.020)+(1.059), (I-749)+(1.020)+(1.092), (I-749)+(1.020)+(2.001), (I-749)+(1.020)+(2.002), (I-749)+(1.020)+(2.003), (I-749)+(1.020)+(2.005), (I-749)+(1.020)+(2.007), (I-749)+(1.020)+(2.009), (I-749)+(1.020)+(2.010), (I-749)+(1.020)+(2.011), (I-749)+(1.020)+(2.012), (I-749)+(1.020)+(2.013), (I-749)+(1.020)+(2.014), (I-749)+(1.020)+(2.015), (I-749)+(1.020)+(2.016), (I-749)+(1.020)+(2.017), (I-749)+(1.020)+(2.018), (I-749)+(1.020)+(2.019), (I-749)+(1.020)+(2.021), (I-749)+(1.020)+(2.028), (I-749)+(1.020)+(2.030), (I-749)+(1.020)+(2.038), (I-749)+(1.020)+(3.003), (I-749)+(1.020)+(3.007), (I-749)+(1.020)+(3.012), (I-749)+(1.020)+(3.013), (I-749)+(1.020)+(3.016), (I-749)+(1.020)+(3.017), (I-749)+(1.020)+(3.020), (I-749)+(1.020)+(3.025), (I-749)+(1.020)+(3.026), (I-749)+(1.020)+(3.030), (I-749)+(1.020)+(3.031), (I-749)+(1.020)+(5.003), (I-749)+(1.020)+(5.004), (I-749)+(1.020)+(5.005), (I-749)+(1.020)+(5.008), (I-749)+(1.020)+(5.009), (I-749)+(1.020)+(5.011), (I-749)+(1.020)+(5.012), (I-749)+(1.020)+(5.013), (I-749)+(1.020)+(5.015), (I-749)+(1.020)+(5.018), (I-749)+(1.020)+(5.019), (I-749)+(1.020)+(6.002), (I-749)+(1.020)+(7.001), (I-749)+(1.020)+(7.005), (I-749)+(1.020)+(9.002), (I-749)+(1.020)+(9.004), (I-749)+(1.020)+(14.001), (I-749)+(1.020)+(14.002), (I-749)+(1.020)+(15.008), (I-749)+(1.020)+(15.011), (I-749)+(1.020)+(15.012), (I-749)+(1.020)+(15.016), (I-749)+(1.020)+(15.025), (I-749)+(1.020)+(15.027), (I-749)+(1.020)+(15.047), (I-749)+(1.020)+(15.063), (I-749)+(1.020)+(15.064), (I-749)+(1.020)+(16.001), (I-749)+(1.020)+(16.005), (I-749)+(1.020)+(17.001), (I-749)+(1.020)+(17.002), (I-749)+(1.020)+(17.003), (I-749)+(1.020)+(17.008), (I-749)+(1.020)+(18.001),

(I-749)+(1.021)+(1.001), (I-749)+(1.021)+(1.002), (I-749)+(1.021)+(1.003), (I-749)+(1.021)+(1.004), (I-749)+(1.021)+(1.005), (I-749)+(1.021)+(1.006), (I-749)+(1.021)+(1.007), (I-749)+(1.021)+(1.010), (I-749)+(1.021)+(1.011), (I-749)+(1.021)+(1.012), (I-749)+(1.021)+(1.013), (I-749)+(1.021)+(1.017), (I-749)+(1.021)+(1.018), (I-749)+(1.021)+(1.020), (I-749)+(1.021)+(1.026), (I-749)+(1.021)+(1.027), (I-749)+(1.021)+(1.055), (I-749)+(1.021)+(1.059), (I-749)+(1.021)+(1.092), (I-749)+(1.021)+(2.001), (I-749)+(1.021)+(2.002), (I-749)+(1.021)+(2.003), (I-749)+(1.021)+(2.005), (I-749)+(1.021)+(2.007), (I-749)+(1.021)+(2.009), (I-749)+(1.021)+(2.010), (I-749)+(1.021)+(2.011), (I-749)+(1.021)+(2.012), (I-749)+(1.021)+(2.013), (I-749)+(1.021)+(2.014), (I-749)+(1.021)+(2.015), (I-749)+(1.021)+(2.016), (I-749)+(1.021)+(2.017), (I-749)+(1.021)+(2.018), (I-749)+(1.021)+(2.019), (I-749)+(1.021)+(2.021), (I-749)+(1.021)+(2.028), (I-749)+(1.021)+(2.030), (I-749)+(1.021)+(2.038), (I-749)+(1.021)+(3.003), (I-749)+(1.021)+(3.007), (I-749)+(1.021)+(3.012), (I-749)+(1.021)+(3.013), (I-749)+(1.021)+(3.016), (I-749)+(1.021)+(3.017), (I-749)+(1.021)+(3.020), (I-749)+(1.021)+(3.025), (I-749)+(1.021)+(3.026), (I-749)+(1.021)+(3.030), (I-749)+(1.021)+(3.031), (I-749)+(1.021)+(5.003), (I-749)+(1.021)+(5.004), (I-749)+(1.021)+(5.005), (I-749)+(1.021)+(5.008), (I-749)+(1.021)+(5.009), (I-749)+(1.021)+(5.011), (I-749)+(1.021)+(5.012), (I-749)+(1.021)+(5.013), (I-749)+(1.021)+(5.015), (I-749)+(1.021)+(5.018), (I-749)+(1.021)+(5.019), (I-749)+(1.021)+(6.002), (I-749)+(1.021)+(7.001), (I-749)+(1.021)+(7.005), (I-749)+(1.021)+(9.002), (I-749)+(1.021)+(9.004), (I-749)+(1.021)+(14.001), (I-749)+(1.021)+(14.002), (I-749)+(1.021)+(15.008), (I-749)+(1.021)+(15.011), (I-749)+(1.021)+(15.012), (I-749)+(1.021)+(15.016), (I-749)+(1.021)+(15.025), (I-749)+(1.021)+(15.027), (I-749)+(1.021)+(15.047), (I-749)+(1.021)+(15.063), (I-749)+(1.021)+(15.064), (I-749)+(1.021)+(16.001), (I-749)+(1.021)+(16.005), (I-749)+(1.021)+(17.001), (I-749)+(1.021)+(17.002), (I-749)+(1.021)+(17.003), (I-749)+(1.021)+(17.008), (I-749)+(1.021)+(18.001),

(I-749)+(1.026)+(1.001), (I-749)+(1.026)+(1.002), (I-749)+(1.026)+(1.003), (I-749)+(1.026)+(1.004), (I-749)+(1.026)+(1.005), (I-749)+(1.026)+(1.006), (I-749)+(1.026)+(1.007), (I-749)+(1.026)+(1.010), (I-749)+(1.026)+(1.011), (I-749)+(1.026)+(1.012), (I-749)+(1.026)+(1.013), (I-749)+(1.026)+(1.017), (I-749)+(1.026)+(1.018), (I-749)+(1.026)+(1.020), (I-749)+(1.026)+(1.021), (I-749)+(1.026)+(1.027), (I-749)+(1.026)+(1.055), (I-749)+(1.026)+(1.059), (I-749)+(1.026)+(1.092), (I-749)+(1.026)+(2.001), (I-749)+(1.026)+(2.002), (I-749)+(1.026)+(2.003), (I-749)+(1.026)+(2.005), (I-749)+(1.026)+(2.007), (I-749)+(1.026)+(2.009), (I-749)+(1.026)+(2.010), (I-749)+(1.026)+(2.011), (I-749)+(1.026)+(2.012), (I-749)+(1.026)+(2.013), (I-749)+(1.026)+(2.014), (I-749)+(1.026)+(2.015), (I-749)+(1.026)+(2.016), (I-749)+(1.026)+(2.017), (I-749)+(1.026)+(2.018), (I-749)+(1.026)+(2.019), (I-749)+(1.026)+(2.021), (I-749)+(1.026)+(2.028), (I-749)+(1.026)+(2.030), (I-749)+(1.026)+(2.038), (I-749)+(1.026)+(3.003), (I-749)+(1.026)+(3.007), (I-749)+(1.026)+(3.012), (I-749)+(1.026)+(3.013), (I-749)+(1.026)+(3.016), (I-749)+(1.026)+(3.017), (I-749)+(1.026)+(3.020), (I-749)+(1.026)+(3.025), (I-749)+(1.026)+(3.026), (I-749)+(1.026)+(3.030), (I-749)+(1.026)+(3.031), (I-749)+(1.026)+(5.003), (I-749)+(1.026)+(5.004), (I-749)+(1.026)+(5.005), (I-749)+(1.026)+(5.008), (I-749)+(1.026)+(5.009), (I-749)+(1.026)+(5.011), (I-749)+(1.026)+(5.012), (I-749)+(1.026)+(5.013), (I-749)+(1.026)+(5.015), (I-749)+(1.026)+(5.018), (I-749)+(1.026)+(5.019), (I-749)+(1.026)+(6.002), (I-749)+(1.026)+(7.001), (I-749)+(1.026)+(7.005), (I-749)+(1.026)+(9.002), (I-749)+(1.026)+(9.004), (I-749)+(1.026)+(14.001), (I-749)+(1.026)+(14.002), (I-749)+(1.026)+(15.008), (I-749)+(1.026)+(15.011), (I-749)+(1.026)+(15.012), (I-749)+(1.026)+(15.016), (I-749)+(1.026)+(15.025), (I-749)+(1.026)+(15.027), (I-749)+(1.026)+(15.047), (I-749)+(1.026)+(15.063), (I-749)+(1.026)+(15.064), (I-749)+(1.026)+(16.001), (I-749)+(1.026)+(16.005), (I-749)+(1.026)+(17.001), (I-749)+(1.026)+(17.002), (I-749)+(1.026)+(17.003), (I-749)+(1.026)+(17.008), (I-749)+(1.026)+(18.001),

(I-749)+(1.027)+(1.001), (I-749)+(1.027)+(1.002), (I-749)+(1.027)+(1.003), (I-749)+(1.027)+(1.004), (I-749)+(1.027)+(1.005), (I-749)+(1.027)+(1.006), (I-749)+(1.027)+(1.007), (I-749)+(1.027)+(1.010), (I-749)+(1.027)+(1.011), (I-749)+(1.027)+(1.012), (I-749)+(1.027)+(1.013), (I-749)+(1.027)+(1.017), (I-749)+(1.027)+(1.018), (I-749)+(1.027)+(1.020), (I-749)+(1.027)+(1.021), (I-749)+(1.027)+(1.026), (I-749)+(1.027)+(1.055), (I-749)+(1.027)+(1.059), (I-749)+(1.027)+(1.092), (I-749)+(1.027)+(2.001), (I-749)+(1.027)+(2.002), (I-749)+(1.027)+(2.003), (I-749)+(1.027)+(2.005), (I-749)+(1.027)+(2.007), (I-749)+(1.027)+(2.009), (I-749)+(1.027)+(2.010), (I-749)+(1.027)+(2.011), (I-749)+(1.027)+(2.012), (I-749)+(1.027)+(2.013), (I-749)+(1.027)+(2.014), (I-749)+(1.027)+(2.015), (I-749)+(1.027)+(2.016), (I-749)+(1.027)+(2.017), (I-749)+(1.027)+(2.018), (I-749)+(1.027)+(2.019), (I-749)+(1.027)+(2.021), (I-749)+(1.027)+(2.028), (I-749)+(1.027)+(2.030), (I-749)+(1.027)+(2.038), (I-749)+(1.027)+(3.003), (I-749)+(1.027)+(3.007), (I-749)+(1.027)+(3.012), (I-749)+(1.027)+(3.013), (I-749)+(1.027)+(3.016), (I-749)+(1.027)+(3.017), (I-749)+(1.027)+(3.020), (I-749)+(1.027)+(3.025), (I-749)+(1.027)+(3.026), (I-749)+(1.027)+(3.030), (I-749)+(1.027)+(3.031), (I-749)+(1.027)+(5.003), (I-749)+(1.027)+(5.004), (I-749)+(1.027)+(5.005), (I-749)+(1.027)+(5.008), (I-749)+(1.027)+(5.009), (I-749)+(1.027)+(5.011), (I-749)+(1.027)+(5.012), (I-749)+(1.027)+(5.013), (I-749)+(1.027)+(5.015), (I-749)+(1.027)+(5.018), (I-749)+(1.027)+(5.019), (I-749)+(1.027)+(6.002), (I-749)+(1.027)+(7.001), (I-749)+(1.027)+(7.005), (I-749)+(1.027)+(9.002), (I-749)+(1.027)+(9.004), (I-749)+(1.027)+(14.001), (I-749)+(1.027)+(14.002), (I-749)+(1.027)+(15.008), (I-749)+(1.027)+(15.011), (I-749)+(1.027)+(15.012), (I-749)+(1.027)+(15.016), (I-749)+(1.027)+(15.025), (I-749)+(1.027)+(15.027), (I-749)+(1.027)+(15.047), (I-749)+(1.027)+(15.063), (I-749)+(1.027)+(15.064), (I-749)+(1.027)+(16.001), (I-749)+(1.027)+(16.005), (I-749)+(1.027)+(17.001), (I-749)+(1.027)+(17.002), (I-749)+(1.027)+(17.003), (I-749)+(1.027)+(17.008), (I-749)+(1.027)+(18.001),

(I-749)+(1.055)+(1.001), (I-749)+(1.055)+(1.002), (I-749)+(1.055)+(1.003), (I-749)+(1.055)+(1.004), (I-749)+(1.055)+(1.005), (I-749)+(1.055)+(1.006), (I-749)+(1.055)+(1.007), (I-749)+(1.055)+(1.010), (I-749)+(1.055)+(1.011), (I-749)+(1.055)+(1.012), (I-749)+(1.055)+(1.013), (I-749)+(1.055)+(1.017), (I-749)+(1.055)+(1.018), (I-749)+(1.055)+(1.020), (I-749)+(1.055)+(1.021), (I-749)+(1.055)+(1.026), (I-749)+(1.055)+(1.027), (I-749)+(1.055)+(1.059), (I-749)+(1.055)+(1.092), (I-749)+(1.055)+(2.001), (I-749)+(1.055)+(2.002), (I-749)+(1.055)+(2.003), (I-749)+(1.055)+(2.005), (I-749)+(1.055)+(2.007), (I-749)+(1.055)+(2.009), (I-749)+(1.055)+(2.010), (I-749)+(1.055)+(2.011), (I-749)+(1.055)+(2.012), (I-749)+(1.055)+(2.013), (I-749)+(1.055)+(2.014), (I-749)+(1.055)+(2.015), (I-749)+(1.055)+(2.016), (I-749)+(1.055)+(2.017), (I-749)+(1.055)+(2.018), (I-749)+(1.055)+(2.019), (I-749)+(1.055)+(2.021), (I-749)+(1.055)+(2.028), (I-749)+(1.055)+(2.030), (I-749)+(1.055)+(2.038), (I-749)+(1.055)+(3.003), (I-749)+(1.055)+(3.007), (I-749)+(1.055)+(3.012), (I-749)+(1.055)+(3.013), (I-749)+(1.055)+(3.016), (I-749)+(1.055)+(3.017), (I-749)+(1.055)+(3.020), (I-749)+(1.055)+(3.025), (I-749)+(1.055)+(3.026), (I-749)+(1.055)+(3.030), (I-749)+(1.055)+(3.031), (I-749)+(1.055)+(5.003), (I-749)+(1.055)+(5.004), (I-749)+(1.055)+(5.005), (I-749)+(1.055)+(5.008), (I-749)+(1.055)+(5.009), (I-749)+(1.055)+(5.011), (I-749)+(1.055)+(5.012), (I-749)+(1.055)+(5.013), (I-749)+(1.055)+(5.015), (I-749)+(1.055)+(5.018), (I-749)+(1.055)+(5.019), (I-749)+(1.055)+(6.002), (I-749)+(1.055)+(7.001), (I-749)+(1.055)+(7.005), (I-749)+(1.055)+(9.002), (I-749)+(1.055)+(9.004), (I-749)+(1.055)+(14.001), (I-749)+(1.055)+(14.002), (I-749)+(1.055)+(15.008), (I-749)+(1.055)+(15.011), (I-749)+(1.055)+(15.012), (I-749)+(1.055)+(15.016), (I-749)+(1.055)+(15.025), (I-749)+(1.055)+(15.027), (I-749)+(1.055)+(15.047), (I-749)+(1.055)+(15.063), (I-749)+(1.055)+(15.064), (I-749)+(1.055)+(16.001), (I-749)+(1.055)+(16.005), (I-749)+(1.055)+(17.001), (I-749)+(1.055)+(17.002), (I-749)+(1.055)+(17.003), (I-749)+(1.055)+(17.008), (I-749)+(1.055)+(18.001),

(I-749)+(1.059)+(1.001), (I-749)+(1.059)+(1.002), (I-749)+(1.059)+(1.003), (I-749)+(1.059)+(1.004), (I-749)+(1.059)+(1.005), (I-749)+(1.059)+(1.006), (I-749)+(1.059)+(1.007), (I-749)+(1.059)+(1.010), (I-749)+(1.059)+(1.011), (I-749)+(1.059)+(1.012), (I-749)+(1.059)+(1.013), (I-749)+(1.059)+(1.017), (I-749)+(1.059)+(1.018), (I-749)+(1.059)+(1.020), (I-749)+(1.059)+(1.021), (I-749)+(1.059)+(1.026), (I-749)+(1.059)+(1.027), (I-749)+(1.059)+(1.055), (I-749)+(1.059)+(1.092), (I-749)+(1.059)+(2.001), (I-749)+(1.059)+(2.002), (I-749)+(1.059)+(2.003), (I-749)+(1.059)+(2.005), (I-749)+(1.059)+(2.007), (I-749)+(1.059)+(2.009), (I-749)+(1.059)+(2.010), (I-749)+(1.059)+(2.011), (I-749)+(1.059)+(2.012), (I-749)+(1.059)+(2.013), (I-749)+(1.059)+(2.014), (I-749)+(1.059)+(2.015), (I-749)+(1.059)+(2.016), (I-749)+(1.059)+(2.017), (I-749)+(1.059)+(2.018), (I-749)+(1.059)+(2.019), (I-749)+(1.059)+(2.021), (I-749)+(1.059)+(2.028), (I-749)+(1.059)+(2.030), (I-749)+(1.059)+(2.038), (I-749)+(1.059)+(3.003), (I-749)+(1.059)+(3.007), (I-749)+(1.059)+(3.012), (I-749)+(1.059)+(3.013), (I-749)+(1.059)+(3.016), (I-749)+(1.059)+(3.017), (I-749)+(1.059)+(3.020), (I-749)+(1.059)+(3.025), (I-749)+(1.059)+(3.026), (I-749)+(1.059)+(3.030), (I-749)+(1.059)+(3.031), (I-749)+(1.059)+(5.003), (I-749)+(1.059)+(5.004), (I-749)+(1.059)+(5.005), (I-749)+(1.059)+(5.008), (I-749)+(1.059)+(5.009), (I-749)+(1.059)+(5.011), (I-749)+(1.059)+(5.012), (I-749)+(1.059)+(5.013), (I-749)+(1.059)+(5.015), (I-749)+(1.059)+(5.018), (I-749)+(1.059)+(5.019), (I-749)+(1.059)+(6.002), (I-749)+(1.059)+(7.001), (I-749)+(1.059)+(7.005), (I-749)+(1.059)+(9.002), (I-749)+(1.059)+(9.004), (I-749)+(1.059)+(14.001), (I-749)+(1.059)+(14.002), (I-749)+(1.059)+(15.008), (I-749)+(1.059)+(15.011), (I-749)+(1.059)+(15.012), (I-749)+(1.059)+(15.016), (I-749)+(1.059)+(15.025), (I-749)+(1.059)+(15.027), (I-749)+(1.059)+(15.047), (I-749)+(1.059)+(15.063), (I-749)+(1.059)+(15.064), (I-749)+(1.059)+(16.001), (I-749)+(1.059)+(16.005), (I-749)+(1.059)+(17.001), (I-749)+(1.059)+(17.002), (I-749)+(1.059)+(17.003), (I-749)+(1.059)+(17.008), (I-749)+(1.059)+(18.001),

(I-749)+(1.092)+(1.001), (I-749)+(1.092)+(1.002), (I-749)+(1.092)+(1.003), (I-749)+(1.092)+(1.004), (I-749)+(1.092)+(1.005), (I-749)+(1.092)+(1.006), (I-749)+(1.092)+(1.007), (I-749)+(1.092)+(1.010), (I-749)+(1.092)+(1.011), (I-749)+(1.092)+(1.012), (I-749)+(1.092)+(1.013), (I-749)+(1.092)+(1.017), (I-749)+(1.092)+(1.018), (I-749)+(1.092)+(1.020), (I-749)+(1.092)+(1.021), (I-749)+(1.092)+(1.026), (I-749)+(1.092)+(1.027), (I-749)+(1.092)+(1.055), (I-749)+(1.092)+(1.059), (I-749)+(1.092)+(2.001), (I-749)+(1.092)+(2.002), (I-749)+(1.092)+(2.003), (I-749)+(1.092)+(2.005), (I-749)+(1.092)+(2.007), (I-749)+(1.092)+(2.009), (I-749)+(1.092)+(2.010), (I-749)+(1.092)+(2.011), (I-749)+(1.092)+(2.012), (I-749)+(1.092)+(2.013), (I-749)+(1.092)+(2.014), (I-749)+(1.092)+(2.015), (I-749)+(1.092)+(2.016), (I-749)+(1.092)+(2.017), (I-749)+(1.092)+(2.018), (I-749)+(1.092)+(2.019), (I-749)+(1.092)+(2.021), (I-749)+(1.092)+(2.028), (I-749)+(1.092)+(2.030), (I-749)+(1.092)+(2.038), (I-749)+(1.092)+(3.003), (I-749)+(1.092)+(3.007), (I-749)+(1.092)+(3.012), (I-749)+(1.092)+(3.013), (I-749)+(1.092)+(3.016), (I-749)+(1.092)+(3.017), (I-749)+(1.092)+(3.020), (I-749)+(1.092)+(3.025), (I-749)+(1.092)+(3.026), (I-749)+(1.092)+(3.030), (I-749)+(1.092)+(3.031), (I-749)+(1.092)+(5.003), (I-749)+(1.092)+(5.004), (I-749)+(1.092)+(5.005), (I-749)+(1.092)+(5.008), (I-749)+(1.092)+(5.009), (I-749)+(1.092)+(5.011), (I-749)+(1.092)+(5.012), (I-749)+(1.092)+(5.013), (I-749)+(1.092)+(5.015), (I-749)+(1.092)+(5.018), (I-749)+(1.092)+(5.019), (I-749)+(1.092)+(6.002), (I-749)+(1.092)+(7.001), (I-749)+(1.092)+(7.005), (I-749)+(1.092)+(9.002), (I-749)+(1.092)+(9.004), (I-749)+(1.092)+(14.001), (I-749)+(1.092)+(14.002), (I-749)+(1.092)+(15.008), (I-749)+(1.092)+(15.011), (I-749)+(1.092)+(15.012), (I-749)+(1.092)+(15.016), (I-749)+(1.092)+(15.025), (I-749)+(1.092)+(15.027), (I-749)+(1.092)+(15.047), (I-749)+(1.092)+(15.063), (I-749)+(1.092)+(15.064), (I-749)+(1.092)+(16.001), (I-749)+(1.092)+(16.005), (I-749)+(1.092)+(17.001), (I-749)+(1.092)+(17.002), (I-749)+(1.092)+(17.003), (I-749)+(1.092)+(17.008), (I-749)+(1.092)+(18.001),

(I-749)+(2.001)+(3.003), (I-749)+(2.001)+(3.007), (I-749)+(2.001)+(3.012), (I-749)+(2.001)+(3.013), (I-749)+(2.001)+(3.016), (I-749)+(2.001)+(3.017), (I-749)+(2.001)+(3.020), (I-749)+(2.001)+(3.025), (I-749)+(2.001)+(3.026), (I-749)+(2.001)+(3.030), (I-749)+(2.001)+(3.031), (I-749)+(2.001)+(5.003), (I-749)+(2.001)+(5.004), (I-749)+(2.001)+(5.005), (I-749)+(2.001)+(5.008), (I-749)+(2.001)+(5.009), (I-749)+(2.001)+(5.011), (I-749)+(2.001)+(5.012), (I-749)+(2.001)+(5.013), (I-749)+(2.001)+(5.015), (I-749)+(2.001)+(5.018), (I-749)+(2.001)+(5.019), (I-749)+(2.001)+(6.002), (I-749)+(2.001)+(7.001), (I-749)+(2.001)+(7.005), (I-749)+(2.001)+(9.002), (I-749)+(2.001)+(9.004), (I-749)+(2.001)+(14.001), (I-749)+(2.001)+(14.002), (I-749)+(2.001)+(15.008), (I-749)+(2.001)+(15.011), (I-749)+(2.001)+(15.012), (I-749)+(2.001)+(15.016), (I-749)+(2.001)+(15.025), (I-749)+(2.001)+(15.027), (I-749)+(2.001)+(15.047), (I-749)+(2.001)+(15.063), (I-749)+(2.001)+(15.064), (I-749)+(2.001)+(16.001), (I-749)+(2.001)+(16.005), (I-749)+(2.001)+(17.001), (I-749)+(2.001)+(17.002), (I-749)+(2.001)+(17.003), (I-749)+(2.001)+(17.008), (I-749)+(2.001)+(18.001),

(I-749)+(2.002)+(3.003), (I-749)+(2.002)+(3.007), (I-749)+(2.002)+(3.012), (I-749)+(2.002)+(3.013), (I-749)+(2.002)+(3.016), (I-749)+(2.002)+(3.017), (I-749)+(2.002)+(3.020), (I-749)+(2.002)+(3.025), (I-749)+(2.002)+(3.026), (I-749)+(2.002)+(3.030), (I-749)+(2.002)+(3.031), (I-749)+(2.002)+(5.003), (I-749)+(2.002)+(5.004), (I-749)+(2.002)+(5.005), (I-749)+(2.002)+(5.008), (I-749)+(2.002)+(5.009), (I-749)+(2.002)+(5.011), (I-749)+(2.002)+(5.012), (I-749)+(2.002)+(5.013), (I-749)+(2.002)+(5.015), (I-749)+(2.002)+(5.018), (I-749)+(2.002)+(5.019), (I-749)+(2.002)+(6.002), (I-749)+(2.002)+(7.001), (I-749)+(2.002)+(7.005), (I-749)+(2.002)+(9.002), (I-749)+(2.002)+(9.004), (I-749)+(2.002)+(14.001), (I-749)+(2.002)+(14.002), (I-749)+(2.002)+(15.008), (I-749)+(2.002)+(15.011), (I-749)+(2.002)+(15.012), (I-749)+(2.002)+(15.016), (I-749)+(2.002)+(15.025), (I-749)+(2.002)+(15.027), (I-749)+(2.002)+(15.047), (I-749)+(2.002)+(15.063), (I-749)+(2.002)+(15.064), (I-749)+(2.002)+(16.001), (I-749)+(2.002)+(16.005), (I-749)+(2.002)+(17.001), (I-749)+(2.002)+(17.002), (I-749)+(2.002)+(17.003), (I-749)+(2.002)+(17.008), (I-749)+(2.002)+(18.001),

(I-749)+(2.003)+(3.003), (I-749)+(2.003)+(3.007), (I-749)+(2.003)+(3.012), (I-749)+(2.003)+(3.013), (I-749)+(2.003)+(3.016), (I-749)+(2.003)+(3.017), (I-749)+(2.003)+(3.020), (I-749)+(2.003)+(3.025), (I-749)+(2.003)+(3.026), (I-749)+(2.003)+(3.030), (I-749)+(2.003)+(3.031), (I-749)+(2.003)+(5.003), (I-749)+(2.003)+(5.004), (I-749)+(2.003)+(5.005), (I-749)+(2.003)+(5.008), (I-749)+(2.003)+(5.009), (I-749)+(2.003)+(5.011), (I-749)+(2.003)+(5.012), (I-749)+(2.003)+(5.013), (I-749)+(2.003)+(5.015), (I-749)+(2.003)+(5.018), (I-749)+(2.003)+(5.019), (I-749)+(2.003)+(6.002), (I-749)+(2.003)+(7.001), (I-749)+(2.003)+(7.005), (I-749)+(2.003)+(9.002), (I-749)+(2.003)+(9.004), (I-749)+(2.003)+(14.001), (I-749)+(2.003)+(14.002), (I-749)+(2.003)+(15.008), (I-749)+(2.003)+(15.011), (I-749)+(2.003)+(15.012), (I-749)+(2.003)+(15.016), (I-749)+(2.003)+(15.025), (I-749)+(2.003)+(15.027), (I-749)+(2.003)+(15.047), (I-749)+(2.003)+(15.063), (I-749)+(2.003)+(15.064), (I-749)+(2.003)+(16.001), (I-749)+(2.003)+(16.005), (I-749)+(2.003)+(17.001), (I-749)+(2.003)+(17.002), (I-749)+(2.003)+(17.003), (I-749)+(2.003)+(17.008), (I-749)+(2.003)+(18.001),

(I-749)+(2.005)+(3.003), (I-749)+(2.005)+(3.007), (I-749)+(2.005)+(3.012), (I-749)+(2.005)+(3.013), (I-749)+(2.005)+(3.016), (I-749)+(2.005)+(3.017), (I-749)+(2.005)+(3.020), (I-749)+(2.005)+(3.025), (I-749)+(2.005)+(3.026), (I-749)+(2.005)+(3.030), (I-749)+(2.005)+(3.031), (I-749)+(2.005)+(5.003), (I-749)+(2.005)+(5.004), (I-749)+(2.005)+(5.005), (I-749)+(2.005)+(5.008), (I-749)+(2.005)+(5.009), (I-749)+(2.005)+(5.011), (I-749)+(2.005)+(5.012), (I-749)+(2.005)+(5.013), (I-749)+(2.005)+(5.015), (I-749)+(2.005)+(5.018), (I-749)+(2.005)+(5.019), (I-749)+(2.005)+(6.002), (I-749)+(2.005)+(7.001), (I-749)+(2.005)+(7.005), (I-749)+(2.005)+(9.002), (I-749)+(2.005)+(9.004), (I-749)+(2.005)+(14.001), (I-749)+(2.005)+(14.002), (I-749)+(2.005)+(15.008), (I-749)+(2.005)+(15.011), (I-749)+(2.005)+(15.012), (I-749)+(2.005)+(15.016), (I-749)+(2.005)+(15.025), (I-749)+(2.005)+(15.027), (I-749)+(2.005)+(15.047), (I-749)+(2.005)+(15.063), (I-749)+(2.005)+(15.064), (I-749)+(2.005)+(16.001), (I-749)+(2.005)+(16.005), (I-749)+(2.005)+(17.001), (I-749)+(2.005)+(17.002), (I-749)+(2.005)+(17.003), (I-749)+(2.005)+(17.008), (I-749)+(2.005)+(18.001),

(I-749)+(2.007)+(3.003), (I-749)+(2.007)+(3.007), (I-749)+(2.007)+(3.012), (I-749)+(2.007)+(3.013), (I-749)+(2.007)+(3.016), (I-749)+(2.007)+(3.017), (I-749)+(2.007)+(3.020), (I-749)+(2.007)+(3.025), (I-749)+(2.007)+(3.026), (I-749)+(2.007)+(3.030), (I-749)+(2.007)+(3.031), (I-749)+(2.007)+(5.003), (I-749)+(2.007)+(5.004), (I-749)+(2.007)+(5.005), (I-749)+(2.007)+(5.008), (I-749)+(2.007)+(5.009), (I-749)+(2.007)+(5.011), (I-749)+(2.007)+(5.012), (I-749)+(2.007)+(5.013), (I-749)+(2.007)+(5.015), (I-749)+(2.007)+(5.018), (I-749)+(2.007)+(5.019), (I-749)+(2.007)+(6.002), (I-749)+(2.007)+(7.001), (I-749)+(2.007)+(7.005), (I-749)+(2.007)+(9.002), (I-749)+(2.007)+(9.004), (I-749)+(2.007)+(14.001), (I-749)+(2.007)+(14.002), (I-749)+(2.007)+(15.008), (I-749)+(2.007)+(15.011), (I-749)+(2.007)+(15.012), (I-749)+(2.007)+(15.016), (I-749)+(2.007)+(15.025), (I-749)+(2.007)+(15.027), (I-749)+(2.007)+(15.047), (I-749)+(2.007)+(15.063), (I-749)+(2.007)+(15.064), (I-749)+(2.007)+(16.001), (I-749)+(2.007)+(16.005), (I-749)+(2.007)+(17.001), (I-749)+(2.007)+(17.002), (I-749)+(2.007)+(17.003), (I-749)+(2.007)+(17.008), (I-749)+(2.007)+(18.001),

(I-749)+(2.009)+(3.003), (I-749)+(2.009)+(3.007), (I-749)+(2.009)+(3.012), (I-749)+(2.009)+(3.013), (I-749)+(2.009)+(3.016), (I-749)+(2.009)+(3.017), (I-749)+(2.009)+(3.020), (I-749)+(2.009)+(3.025), (I-749)+(2.009)+(3.026), (I-749)+(2.009)+(3.030), (I-749)+(2.009)+(3.031), (I-749)+(2.009)+(5.003), (I-749)+(2.009)+(5.004), (I-749)+(2.009)+(5.005), (I-749)+(2.009)+(5.008), (I-749)+(2.009)+(5.009), (I-749)+(2.009)+(5.011), (I-749)+(2.009)+(5.012), (I-749)+(2.009)+(5.013), (I-749)+(2.009)+(5.015), (I-749)+(2.009)+(5.018), (I-749)+(2.009)+(5.019), (I-749)+(2.009)+(6.002), (I-749)+(2.009)+(7.001), (I-749)+(2.009)+(7.005), (I-749)+(2.009)+(9.002), (I-749)+(2.009)+(9.004), (I-749)+(2.009)+(14.001), (I-749)+(2.009)+(14.002), (I-749)+(2.009)+(15.008), (I-749)+(2.009)+(15.011), (I-749)+(2.009)+(15.012), (I-749)+(2.009)+(15.016), (I-749)+(2.009)+(15.025), (I-749)+(2.009)+(15.027), (I-749)+(2.009)+(15.047), (I-749)+(2.009)+(15.063), (I-749)+(2.009)+(15.064), (I-749)+(2.009)+(16.001), (I-749)+(2.009)+(16.005), (I-749)+(2.009)+(17.001), (I-749)+(2.009)+(17.002), (I-749)+(2.009)+(17.003), (I-749)+(2.009)+(17.008), (I-749)+(2.009)+(18.001),

(I-749)+(2.010)+(3.003), (I-749)+(2.010)+(3.007), (I-749)+(2.010)+(3.012), (I-749)+(2.010)+(3.013), (I-749)+(2.010)+(3.016), (I-749)+(2.010)+(3.017), (I-749)+(2.010)+(3.020), (I-749)+(2.010)+(3.025), (I-749)+(2.010)+(3.026), (I-749)+(2.010)+(3.030), (I-749)+(2.010)+(3.031), (I-749)+(2.010)+(5.003), (I-749)+(2.010)+(5.004), (I-749)+(2.010)+(5.005), (I-749)+(2.010)+(5.008), (I-749)+(2.010)+(5.009), (I-749)+(2.010)+(5.011), (I-749)+(2.010)+(5.012), (I-749)+(2.010)+(5.013), (I-749)+(2.010)+(5.015), (I-749)+(2.010)+(5.018), (I-749)+(2.010)+(5.019), (I-749)+(2.010)+(6.002), (I-749)+(2.010)+(7.001), (I-749)+(2.010)+(7.005), (I-749)+(2.010)+(9.002), (I-749)+(2.010)+(9.004), (I-749)+(2.010)+(14.001), (I-749)+(2.010)+(14.002), (I-749)+(2.010)+(15.008), (I-749)+(2.010)+(15.011), (I-749)+(2.010)+(15.012), (I-749)+(2.010)+(15.016), (I-749)+(2.010)+(15.025), (I-749)+(2.010)+(15.027), (I-749)+(2.010)+(15.047), (I-749)+(2.010)+(15.063), (I-749)+(2.010)+(15.064), (I-749)+(2.010)+(16.001), (I-749)+(2.010)+(16.005), (I-749)+(2.010)+(17.001), (I-749)+(2.010)+(17.002), (I-749)+(2.010)+(17.003), (I-749)+(2.010)+(17.008), (I-749)+(2.010)+(18.001),

(I-749)+(2.011)+(3.003), (I-749)+(2.011)+(3.007), (I-749)+(2.011)+(3.012), (I-749)+(2.011)+(3.013), (I-749)+(2.011)+(3.016), (I-749)+(2.011)+(3.017), (I-749)+(2.011)+(3.020), (I-749)+(2.011)+(3.025), (I-749)+(2.011)+(3.026), (I-749)+(2.011)+(3.030), (I-749)+(2.011)+(3.031), (I-749)+(2.011)+(5.003), (I-749)+(2.011)+(5.004), (I-749)+(2.011)+(5.005), (I-749)+(2.011)+(5.008), (I-749)+(2.011)+(5.009), (I-749)+(2.011)+(5.011), (I-749)+(2.011)+(5.012), (I-749)+(2.011)+(5.013), (I-749)+(2.011)+(5.015), (I-749)+(2.011)+(5.018), (I-749)+(2.011)+(5.019), (I-749)+(2.011)+(6.002), (I-749)+(2.011)+(7.001), (I-749)+(2.011)+(7.005), (I-749)+(2.011)+(9.002), (I-749)+(2.011)+(9.004), (I-749)+(2.011)+(14.001), (I-749)+(2.011)+(14.002), (I-749)+(2.011)+(15.008), (I-749)+(2.011)+(15.011), (I-749)+(2.011)+(15.012), (I-749)+(2.011)+(15.016), (I-749)+(2.011)+(15.025), (I-749)+(2.011)+(15.027), (I-749)+(2.011)+(15.047), (I-749)+(2.011)+(15.063), (I-749)+(2.011)+(15.064), (I-749)+(2.011)+(16.001), (I-749)+(2.011)+(16.005), (I-749)+(2.011)+(17.001), (I-749)+(2.011)+(17.002), (I-749)+(2.011)+(17.003), (I-749)+(2.011)+(17.008), (I-749)+(2.011)+(18.001),

(I-749)+(2.012)+(3.003), (I-749)+(2.012)+(3.007), (I-749)+(2.012)+(3.012), (I-749)+(2.012)+(3.013), (I-749)+(2.012)+(3.016), (I-749)+(2.012)+(3.017), (I-749)+(2.012)+(3.020), (I-749)+(2.012)+(3.025), (I-749)+(2.012)+(3.026), (I-749)+(2.012)+(3.030), (I-749)+(2.012)+(3.031), (I-749)+(2.012)+(5.003), (I-749)+(2.012)+(5.004), (I-749)+(2.012)+(5.005), (I-749)+(2.012)+(5.008), (I-749)+(2.012)+(5.009), (I-749)+(2.012)+(5.011), (I-749)+(2.012)+(5.012), (I-749)+(2.012)+(5.013), (I-749)+(2.012)+(5.015), (I-749)+(2.012)+(5.018), (I-749)+(2.012)+(5.019), (I-749)+(2.012)+(6.002), (I-749)+(2.012)+(7.001), (I-749)+(2.012)+(7.005), (I-749)+(2.012)+(9.002), (I-749)+(2.012)+(9.004), (I-749)+(2.012)+(14.001), (I-749)+(2.012)+(14.002), (I-749)+(2.012)+(15.008), (I-749)+(2.012)+(15.011), (I-749)+(2.012)+(15.012), (I-749)+(2.012)+(15.016), (I-749)+(2.012)+(15.025), (I-749)+(2.012)+(15.027), (I-749)+(2.012)+(15.047), (I-749)+(2.012)+(15.063), (I-749)+(2.012)+(15.064), (I-749)+(2.012)+(16.001), (I-749)+(2.012)+(16.005), (I-749)+(2.012)+(17.001), (I-749)+(2.012)+(17.002), (I-749)+(2.012)+(17.003), (I-749)+(2.012)+(17.008), (I-749)+(2.012)+(18.001),

(I-749)+(2.013)+(3.003), (I-749)+(2.013)+(3.007), (I-749)+(2.013)+(3.012), (I-749)+(2.013)+(3.013), (I-749)+(2.013)+(3.016), (I-749)+(2.013)+(3.017), (I-749)+(2.013)+(3.020), (I-749)+(2.013)+(3.025), (I-749)+(2.013)+(3.026), (I-749)+(2.013)+(3.030), (I-749)+(2.013)+(3.031), (I-749)+(2.013)+(5.003), (I-749)+(2.013)+(5.004), (I-749)+(2.013)+(5.005), (I-749)+(2.013)+(5.008), (I-749)+(2.013)+(5.009), (I-749)+(2.013)+(5.011), (I-749)+(2.013)+(5.012), (I-749)+(2.013)+(5.013), (I-749)+(2.013)+(5.015), (I-749)+(2.013)+(5.018), (I-749)+(2.013)+(5.019), (I-749)+(2.013)+(6.002), (I-749)+(2.013)+(7.001), (I-749)+(2.013)+(7.005), (I-749)+(2.013)+(9.002), (I-749)+(2.013)+(9.004), (I-749)+(2.013)+(14.001), (I-749)+(2.013)+(14.002), (I-749)+(2.013)+(15.008), (I-749)+(2.013)+(15.011), (I-749)+(2.013)+(15.012), (I-749)+(2.013)+(15.016), (I-749)+(2.013)+(15.025), (I-749)+(2.013)+(15.027), (I-749)+(2.013)+(15.047), (I-749)+(2.013)+(15.063), (I-749)+(2.013)+(15.064), (I-749)+(2.013)+(16.001), (I-749)+(2.013)+(16.005), (I-749)+(2.013)+(17.001), (I-749)+(2.013)+(17.002), (I-749)+(2.013)+(17.003), (I-749)+(2.013)+(17.008), (I-749)+(2.013)+(18.001),

(I-749)+(2.014)+(3.003), (I-749)+(2.014)+(3.007), (I-749)+(2.014)+(3.012), (I-749)+(2.014)+(3.013), (I-749)+(2.014)+(3.016), (I-749)+(2.014)+(3.017), (I-749)+(2.014)+(3.020), (I-749)+(2.014)+(3.025), (I-749)+(2.014)+(3.026), (I-749)+(2.014)+(3.030), (I-749)+(2.014)+(3.031), (I-749)+(2.014)+(5.003), (I-749)+(2.014)+(5.004), (I-749)+(2.014)+(5.005), (I-749)+(2.014)+(5.008), (I-749)+(2.014)+(5.009), (I-749)+(2.014)+(5.011), (I-749)+(2.014)+(5.012), (I-749)+(2.014)+(5.013), (I-749)+(2.014)+(5.015), (I-749)+(2.014)+(5.018), (I-749)+(2.014)+(5.019), (I-749)+(2.014)+(6.002), (I-749)+(2.014)+(7.001), (I-749)+(2.014)+(7.005), (I-749)+(2.014)+(9.002), (I-749)+(2.014)+(9.004), (I-749)+(2.014)+(14.001), (I-749)+(2.014)+(14.002), (I-749)+(2.014)+(15.008), (I-749)+(2.014)+(15.011), (I-749)+(2.014)+(15.012), (I-749)+(2.014)+(15.016), (I-749)+(2.014)+(15.025), (I-749)+(2.014)+(15.027), (I-749)+(2.014)+(15.047), (I-749)+(2.014)+(15.063), (I-749)+(2.014)+(15.064), (I-749)+(2.014)+(16.001), (I-749)+(2.014)+(16.005), (I-749)+(2.014)+(17.001), (I-749)+(2.014)+(17.002), (I-749)+(2.014)+(17.003), (I-749)+(2.014)+(17.008), (I-749)+(2.014)+(18.001),

(I-749)+(2.015)+(3.003), (I-749)+(2.015)+(3.007), (I-749)+(2.015)+(3.012), (I-749)+(2.015)+(3.013), (I-749)+(2.015)+(3.016), (I-749)+(2.015)+(3.017), (I-749)+(2.015)+(3.020), (I-749)+(2.015)+(3.025), (I-749)+(2.015)+(3.026), (I-749)+(2.015)+(3.030), (I-749)+(2.015)+(3.031), (I-749)+(2.015)+(5.003), (I-749)+(2.015)+(5.004), (I-749)+(2.015)+(5.005), (I-749)+(2.015)+(5.008), (I-749)+(2.015)+(5.009), (I-749)+(2.015)+(5.011), (I-749)+(2.015)+(5.012), (I-749)+(2.015)+(5.013), (I-749)+(2.015)+(5.015), (I-749)+(2.015)+(5.018), (I-749)+(2.015)+(5.019), (I-749)+(2.015)+(6.002), (I-749)+(2.015)+(7.001), (I-749)+(2.015)+(7.005), (I-749)+(2.015)+(9.002), (I-749)+(2.015)+(9.004), (I-749)+(2.015)+(14.001), (I-749)+(2.015)+(14.002), (I-749)+(2.015)+(15.008), (I-749)+(2.015)+(15.011), (I-749)+(2.015)+(15.012), (I-749)+(2.015)+(15.016), (I-749)+(2.015)+(15.025), (I-749)+(2.015)+(15.027), (I-749)+(2.015)+(15.047), (I-749)+(2.015)+(15.063), (I-749)+(2.015)+(15.064), (I-749)+(2.015)+(16.001), (I-749)+(2.015)+(16.005), (I-749)+(2.015)+(17.001), (I-749)+(2.015)+(17.002), (I-749)+(2.015)+(17.003), (I-749)+(2.015)+(17.008), (I-749)+(2.015)+(18.001),

(I-749)+(2.016)+(3.003), (I-749)+(2.016)+(3.007), (I-749)+(2.016)+(3.012), (I-749)+(2.016)+(3.013), (I-749)+(2.016)+(3.016), (I-749)+(2.016)+(3.017), (I-749)+(2.016)+(3.020), (I-749)+(2.016)+(3.025), (I-749)+(2.016)+(3.026), (I-749)+(2.016)+(3.030), (I-749)+(2.016)+(3.031), (I-749)+(2.016)+(5.003), (I-749)+(2.016)+(5.004), (I-749)+(2.016)+(5.005), (I-749)+(2.016)+(5.008), (I-749)+(2.016)+(5.009), (I-749)+(2.016)+(5.011), (I-749)+(2.016)+(5.012), (I-749)+(2.016)+(5.013), (I-749)+(2.016)+(5.015), (I-749)+(2.016)+(5.018), (I-749)+(2.016)+(5.019), (I-749)+(2.016)+(6.002), (I-749)+(2.016)+(7.001), (I-749)+(2.016)+(7.005), (I-749)+(2.016)+(9.002), (I-749)+(2.016)+(9.004), (I-749)+(2.016)+(14.001), (I-749)+(2.016)+(14.002), (I-749)+(2.016)+(15.008), (I-749)+(2.016)+(15.011), (I-749)+(2.016)+(15.012), (I-749)+(2.016)+(15.016), (I-749)+(2.016)+(15.025), (I-749)+(2.016)+(15.027), (I-749)+(2.016)+(15.047), (I-749)+(2.016)+(15.063), (I-749)+(2.016)+(15.064), (I-749)+(2.016)+(16.001), (I-749)+(2.016)+(16.005), (I-749)+(2.016)+(17.001), (I-749)+(2.016)+(17.002), (I-749)+(2.016)+(17.003), (I-749)+(2.016)+(17.008), (I-749)+(2.016)+(18.001),

(I-749)+(2.017)+(3.003), (I-749)+(2.017)+(3.007), (I-749)+(2.017)+(3.012), (I-749)+(2.017)+(3.013), (I-749)+(2.017)+(3.016), (I-749)+(2.017)+(3.017), (I-749)+(2.017)+(3.020), (I-749)+(2.017)+(3.025), (I-749)+(2.017)+(3.026), (I-749)+(2.017)+(3.030), (I-749)+(2.017)+(3.031), (I-749)+(2.017)+(5.003), (I-749)+(2.017)+(5.004), (I-749)+(2.017)+(5.005), (I-749)+(2.017)+(5.008), (I-749)+(2.017)+(5.009), (I-749)+(2.017)+(5.011), (I-749)+(2.017)+(5.012), (I-749)+(2.017)+(5.013), (I-749)+(2.017)+(5.015), (I-749)+(2.017)+(5.018), (I-749)+(2.017)+(5.019), (I-749)+(2.017)+(6.002), (I-749)+(2.017)+(7.001), (I-749)+(2.017)+(7.005), (I-749)+(2.017)+(9.002), (I-749)+(2.017)+(9.004), (I-749)+(2.017)+(14.001), (I-749)+(2.017)+(14.002), (I-749)+(2.017)+(15.008), (I-749)+(2.017)+(15.011), (I-749)+(2.017)+(15.012), (I-749)+(2.017)+(15.016), (I-749)+(2.017)+(15.025), (I-749)+(2.017)+(15.027), (I-749)+(2.017)+(15.047), (I-749)+(2.017)+(15.063), (I-749)+(2.017)+(15.064), (I-749)+(2.017)+(16.001), (I-749)+(2.017)+(16.005), (I-749)+(2.017)+(17.001), (I-749)+(2.017)+(17.002), (I-749)+(2.017)+(17.003), (I-749)+(2.017)+(17.008), (I-749)+(2.017)+(18.001),

(I-749)+(2.018)+(3.003), (I-749)+(2.018)+(3.007), (I-749)+(2.018)+(3.012), (I-749)+(2.018)+(3.013), (I-749)+(2.018)+(3.016), (I-749)+(2.018)+(3.017), (I-749)+(2.018)+(3.020), (I-749)+(2.018)+(3.025), (I-749)+(2.018)+(3.026), (I-749)+(2.018)+(3.030), (I-749)+(2.018)+(3.031), (I-749)+(2.018)+(5.003), (I-749)+(2.018)+(5.004), (I-749)+(2.018)+(5.005), (I-749)+(2.018)+(5.008), (I-749)+(2.018)+(5.009), (I-749)+(2.018)+(5.011), (I-749)+(2.018)+(5.012), (I-749)+(2.018)+(5.013), (I-749)+(2.018)+(5.015), (I-749)+(2.018)+(5.018), (I-749)+(2.018)+(5.019), (I-749)+(2.018)+(6.002), (I-749)+(2.018)+(7.001), (I-749)+(2.018)+(7.005), (I-749)+(2.018)+(9.002), (I-749)+(2.018)+(9.004), (I-749)+(2.018)+(14.001), (I-749)+(2.018)+(14.002), (I-749)+(2.018)+(15.008), (I-749)+(2.018)+(15.011), (I-749)+(2.018)+(15.012), (I-749)+(2.018)+(15.016), (I-749)+(2.018)+(15.025), (I-749)+(2.018)+(15.027), (I-749)+(2.018)+(15.047), (I-749)+(2.018)+(15.063), (I-749)+(2.018)+(15.064), (I-749)+(2.018)+(16.001), (I-749)+(2.018)+(16.005), (I-749)+(2.018)+(17.001), (I-749)+(2.018)+(17.002), (I-749)+(2.018)+(17.003), (I-749)+(2.018)+(17.008), (I-749)+(2.018)+(18.001),

(I-749)+(2.019)+(3.003), (I-749)+(2.019)+(3.007), (I-749)+(2.019)+(3.012), (I-749)+(2.019)+(3.013), (I-749)+(2.019)+(3.016), (I-749)+(2.019)+(3.017), (I-749)+(2.019)+(3.020), (I-749)+(2.019)+(3.025), (I-749)+(2.019)+(3.026), (I-749)+(2.019)+(3.030), (I-749)+(2.019)+(3.031), (I-749)+(2.019)+(5.003), (I-749)+(2.019)+(5.004), (I-749)+(2.019)+(5.005), (I-749)+(2.019)+(5.008), (I-749)+(2.019)+(5.009), (I-749)+(2.019)+(5.011), (I-749)+(2.019)+(5.012), (I-749)+(2.019)+(5.013), (I-749)+(2.019)+(5.015), (I-749)+(2.019)+(5.018), (I-749)+(2.019)+(5.019), (I-749)+(2.019)+(6.002), (I-749)+(2.019)+(7.001), (I-749)+(2.019)+(7.005), (I-749)+(2.019)+(9.002), (I-749)+(2.019)+(9.004), (I-749)+(2.019)+(14.001), (I-749)+(2.019)+(14.002), (I-749)+(2.019)+(15.008), (I-749)+(2.019)+(15.011), (I-749)+(2.019)+(15.012), (I-749)+(2.019)+(15.016), (I-749)+(2.019)+(15.025), (I-749)+(2.019)+(15.027), (I-749)+(2.019)+(15.047), (I-749)+(2.019)+(15.063), (I-749)+(2.019)+(15.064), (I-749)+(2.019)+(16.001), (I-749)+(2.019)+(16.005), (I-749)+(2.019)+(17.001), (I-749)+(2.019)+(17.002), (I-749)+(2.019)+(17.003), (I-749)+(2.019)+(17.008), (I-749)+(2.019)+(18.001),

(I-749)+(2.021)+(3.003), (I-749)+(2.021)+(3.007), (I-749)+(2.021)+(3.012), (I-749)+(2.021)+(3.013), (I-749)+(2.021)+(3.016), (I-749)+(2.021)+(3.017), (I-749)+(2.021)+(3.020), (I-749)+(2.021)+(3.025), (I-749)+(2.021)+(3.026), (I-749)+(2.021)+(3.030), (I-749)+(2.021)+(3.031), (I-749)+(2.021)+(5.003), (I-749)+(2.021)+(5.004), (I-749)+(2.021)+(5.005), (I-749)+(2.021)+(5.008), (I-749)+(2.021)+(5.009), (I-749)+(2.021)+(5.011), (I-749)+(2.021)+(5.012), (I-749)+(2.021)+(5.013), (I-749)+(2.021)+(5.015), (I-749)+(2.021)+(5.018), (I-749)+(2.021)+(5.019), (I-749)+(2.021)+(6.002), (I-749)+(2.021)+(7.001), (I-749)+(2.021)+(7.005), (I-749)+(2.021)+(9.002), (I-749)+(2.021)+(9.004), (I-749)+(2.021)+(14.001), (I-749)+(2.021)+(14.002), (I-749)+(2.021)+(15.008), (I-749)+(2.021)+(15.011), (I-749)+(2.021)+(15.012), (I-749)+(2.021)+(15.016), (I-749)+(2.021)+(15.025), (I-749)+(2.021)+(15.027), (I-749)+(2.021)+(15.047), (I-749)+(2.021)+(15.063), (I-749)+(2.021)+(15.064), (I-749)+(2.021)+(16.001), (I-749)+(2.021)+(16.005), (I-749)+(2.021)+(17.001), (I-749)+(2.021)+(17.002), (I-749)+(2.021)+(17.003), (I-749)+(2.021)+(17.008), (I-749)+(2.021)+(18.001),

(I-749)+(2.028)+(3.003), (I-749)+(2.028)+(3.007), (I-749)+(2.028)+(3.012), (I-749)+(2.028)+(3.013), (I-749)+(2.028)+(3.016), (I-749)+(2.028)+(3.017), (I-749)+(2.028)+(3.020), (I-749)+(2.028)+(3.025), (I-749)+(2.028)+(3.026), (I-749)+(2.028)+(3.030), (I-749)+(2.028)+(3.031), (I-749)+(2.028)+(5.003), (I-749)+(2.028)+(5.004), (I-749)+(2.028)+(5.005), (I-749)+(2.028)+(5.008), (I-749)+(2.028)+(5.009), (I-749)+(2.028)+(5.011), (I-749)+(2.028)+(5.012), (I-749)+(2.028)+(5.013), (I-749)+(2.028)+(5.015), (I-749)+(2.028)+(5.018), (I-749)+(2.028)+(5.019), (I-749)+(2.028)+(6.002), (I-749)+(2.028)+(7.001), (I-749)+(2.028)+(7.005), (I-749)+(2.028)+(9.002), (I-749)+(2.028)+(9.004), (I-749)+(2.028)+(14.001), (I-749)+(2.028)+(14.002), (I-749)+(2.028)+(15.008), (I-749)+(2.028)+(15.011), (I-749)+(2.028)+(15.012), (I-749)+(2.028)+(15.016), (I-749)+(2.028)+(15.025), (I-749)+(2.028)+(15.027), (I-749)+(2.028)+(15.047), (I-749)+(2.028)+(15.063), (I-749)+(2.028)+(15.064), (I-749)+(2.028)+(16.001), (I-749)+(2.028)+(16.005), (I-749)+(2.028)+(17.001), (I-749)+(2.028)+(17.002), (I-749)+(2.028)+(17.003), (I-749)+(2.028)+(17.008), (I-749)+(2.028)+(18.001),

(I-749)+(2.030)+(3.003), (I-749)+(2.030)+(3.007), (I-749)+(2.030)+(3.012), (I-749)+(2.030)+(3.013), (I-749)+(2.030)+(3.016), (I-749)+(2.030)+(3.017), (I-749)+(2.030)+(3.020), (I-749)+(2.030)+(3.025), (I-749)+(2.030)+(3.026), (I-749)+(2.030)+(3.030), (I-749)+(2.030)+(3.031), (I-749)+(2.030)+(5.003), (I-749)+(2.030)+(5.004), (I-749)+(2.030)+(5.005), (I-749)+(2.030)+(5.008), (I-749)+(2.030)+(5.009), (I-749)+(2.030)+(5.011), (I-749)+(2.030)+(5.012), (I-749)+(2.030)+(5.013), (I-749)+(2.030)+(5.015), (I-749)+(2.030)+(5.018), (I-749)+(2.030)+(5.019), (I-749)+(2.030)+(6.002), (I-749)+(2.030)+(7.001), (I-749)+(2.030)+(7.005), (I-749)+(2.030)+(9.002), (I-749)+(2.030)+(9.004), (I-749)+(2.030)+(14.001), (I-749)+(2.030)+(14.002), (I-749)+(2.030)+(15.008), (I-749)+(2.030)+(15.011), (I-749)+(2.030)+(15.012), (I-749)+(2.030)+(15.016), (I-749)+(2.030)+(15.025), (I-749)+(2.030)+(15.027), (I-749)+(2.030)+(15.047), (I-749)+(2.030)+(15.063), (I-749)+(2.030)+(15.064), (I-749)+(2.030)+(16.001), (I-749)+(2.030)+(16.005), (I-749)+(2.030)+(17.001), (I-749)+(2.030)+(17.002), (I-749)+(2.030)+(17.003), (I-749)+(2.030)+(17.008), (I-749)+(2.030)+(18.001),

(I-749)+(2.038)+(3.003), (I-749)+(2.038)+(3.007), (I-749)+(2.038)+(3.012), (I-749)+(2.038)+(3.013), (I-749)+(2.038)+(3.016), (I-749)+(2.038)+(3.017), (I-749)+(2.038)+(3.020), (I-749)+(2.038)+(3.025), (I-749)+(2.038)+(3.026), (I-749)+(2.038)+(3.030), (I-749)+(2.038)+(3.031), (I-749)+(2.038)+(5.003), (I-749)+(2.038)+(5.004), (I-749)+(2.038)+(5.005), (I-749)+(2.038)+(5.008), (I-749)+(2.038)+(5.009), (I-749)+(2.038)+(5.011), (I-749)+(2.038)+(5.012), (I-749)+(2.038)+(5.013), (I-749)+(2.038)+(5.015), (I-749)+(2.038)+(5.018), (I-749)+(2.038)+(5.019), (I-749)+(2.038)+(6.002), (I-749)+(2.038)+(7.001), (I-749)+(2.038)+(7.005), (I-749)+(2.038)+(9.002), (I-749)+(2.038)+(9.004), (I-749)+(2.038)+(14.001), (I-749)+(2.038)+(14.002), (I-749)+(2.038)+(15.008), (I-749)+(2.038)+(15.011), (I-749)+(2.038)+(15.012), (I-749)+(2.038)+(15.016), (I-749)+(2.038)+(15.025), (I-749)+(2.038)+(15.027), (I-749)+(2.038)+(15.047), (I-749)+(2.038)+(15.063), (I-749)+(2.038)+(15.064), (I-749)+(2.038)+(16.001), (I-749)+(2.038)+(16.005), (I-749)+(2.038)+(17.001), (I-749)+(2.038)+(17.002), (I-749)+(2.038)+(17.003), (I-749)+(2.038)+(17.008), (I-749)+(2.038)+(18.001),

(I-749)+(3.003)+(3.025), (I-749)+(3.003)+(3.030), (I-749)+(3.003)+(3.031), (I-749)+(3.003)+(5.003), (I-749)+(3.003)+(5.004), (I-749)+(3.003)+(5.005), (I-749)+(3.003)+(5.008), (I-749)+(3.003)+(5.009), (I-749)+(3.003)+(5.011), (I-749)+(3.003)+(5.012), (I-749)+(3.003)+(5.013), (I-749)+(3.003)+(5.015), (I-749)+(3.003)+(5.018), (I-749)+(3.003)+(5.019), (I-749)+(3.003)+(6.002), (I-749)+(3.003)+(7.001), (I-749)+(3.003)+(7.005), (I-749)+(3.003)+(9.002), (I-749)+(3.003)+(9.004), (I-749)+(3.003)+(14.001), (I-749)+(3.003)+(14.002), (I-749)+(3.003)+(15.008), (I-749)+(3.003)+(15.011), (I-749)+(3.003)+(15.012), (I-749)+(3.003)+(15.016), (I-749)+(3.003)+(15.025), (I-749)+(3.003)+(15.027), (I-749)+(3.003)+(15.047), (I-749)+(3.003)+(15.063), (I-749)+(3.003)+(15.064), (I-749)+(3.003)+(16.001), (I-749)+(3.003)+(16.005), (I-749)+(3.003)+(17.001), (I-749)+(3.003)+(17.002), (I-749)+(3.003)+(17.003), (I-749)+(3.003)+(17.008), (I-749)+(3.003)+(18.001),

(I-749)+(3.007)+(3.025), (I-749)+(3.007)+(3.030), (I-749)+(3.007)+(3.031), (I-749)+(3.007)+(5.003), (I-749)+(3.007)+(5.004), (I-749)+(3.007)+(5.005), (I-749)+(3.007)+(5.008), (I-749)+(3.007)+(5.009), (I-749)+(3.007)+(5.011), (I-749)+(3.007)+(5.012), (I-749)+(3.007)+(5.013), (I-749)+(3.007)+(5.015), (I-749)+(3.007)+(5.018), (I-749)+(3.007)+(5.019), (I-749)+(3.007)+(6.002), (I-749)+(3.007)+(7.001), (I-749)+(3.007)+(7.005), (I-749)+(3.007)+(9.002), (I-749)+(3.007)+(9.004), (I-749)+(3.007)+(14.001), (I-749)+(3.007)+(14.002), (I-749)+(3.007)+(15.008), (I-749)+(3.007)+(15.011), (I-749)+(3.007)+(15.012), (I-749)+(3.007)+(15.016), (I-749)+(3.007)+(15.025), (I-749)+(3.007)+(15.027), (I-749)+(3.007)+(15.047), (I-749)+(3.007)+(15.063), (I-749)+(3.007)+(15.064), (I-749)+(3.007)+(16.001), (I-749)+(3.007)+(16.005), (I-749)+(3.007)+(17.001), (I-749)+(3.007)+(17.002), (I-749)+(3.007)+(17.003), (I-749)+(3.007)+(17.008), (I-749)+(3.007)+(18.001),

(I-749)+(3.012)+(3.025), (I-749)+(3.012)+(3.030), (I-749)+(3.012)+(3.031), (I-749)+(3.012)+(5.003), (I-749)+(3.012)+(5.004), (I-749)+(3.012)+(5.005), (I-749)+(3.012)+(5.008), (I-749)+(3.012)+(5.009), (I-749)+(3.012)+(5.011), (I-749)+(3.012)+(5.012), (I-749)+(3.012)+(5.013), (I-749)+(3.012)+(5.015), (I-749)+(3.012)+(5.018), (I-749)+(3.012)+(5.019), (I-749)+(3.012)+(6.002), (I-749)+(3.012)+(7.001), (I-749)+(3.012)+(7.005), (I-749)+(3.012)+(9.002), (I-749)+(3.012)+(9.004), (I-749)+(3.012)+(14.001), (I-749)+(3.012)+(14.002), (I-749)+(3.012)+(15.008), (I-749)+(3.012)+(15.011), (I-749)+(3.012)+(15.012), (I-749)+(3.012)+(15.016), (I-749)+(3.012)+(15.025), (I-749)+(3.012)+(15.027), (I-749)+(3.012)+(15.047), (I-749)+(3.012)+(15.063), (I-749)+(3.012)+(15.064), (I-749)+(3.012)+(16.001), (I-749)+(3.012)+(16.005), (I-749)+(3.012)+(17.001), (I-749)+(3.012)+(17.002), (I-749)+(3.012)+(17.003), (I-749)+(3.012)+(17.008), (I-749)+(3.012)+(18.001),

(I-749)+(3.013)+(3.025), (I-749)+(3.013)+(3.030), (I-749)+(3.013)+(3.031), (I-749)+(3.013)+(5.003), (I-749)+(3.013)+(5.004), (I-749)+(3.013)+(5.005), (I-749)+(3.013)+(5.008), (I-749)+(3.013)+(5.009), (I-749)+(3.013)+(5.011), (I-749)+(3.013)+(5.012), (I-749)+(3.013)+(5.013), (I-749)+(3.013)+(5.015), (I-749)+(3.013)+(5.018), (I-749)+(3.013)+(5.019), (I-749)+(3.013)+(6.002), (I-749)+(3.013)+(7.001), (I-749)+(3.013)+(7.005), (I-749)+(3.013)+(9.002), (I-749)+(3.013)+(9.004), (I-749)+(3.013)+(14.001), (I-749)+(3.013)+(14.002), (I-749)+(3.013)+(15.008), (I-749)+(3.013)+(15.011), (I-749)+(3.013)+(15.012), (I-749)+(3.013)+(15.016), (I-749)+(3.013)+(15.025), (I-749)+(3.013)+(15.027), (I-749)+(3.013)+(15.047), (I-749)+(3.013)+(15.063), (I-749)+(3.013)+(15.064), (I-749)+(3.013)+(16.001), (I-749)+(3.013)+(16.005), (I-749)+(3.013)+(17.001), (I-749)+(3.013)+(17.002), (I-749)+(3.013)+(17.003), (I-749)+(3.013)+(17.008), (I-749)+(3.013)+(18.001),

(I-749)+(3.016)+(3.025), (I-749)+(3.016)+(3.030), (I-749)+(3.016)+(3.031), (I-749)+(3.016)+(5.003), (I-749)+(3.016)+(5.004), (I-749)+(3.016)+(5.005), (I-749)+(3.016)+(5.008), (I-749)+(3.016)+(5.009), (I-749)+(3.016)+(5.011), (I-749)+(3.016)+(5.012), (I-749)+(3.016)+(5.013), (I-749)+(3.016)+(5.015), (I-749)+(3.016)+(5.018), (I-749)+(3.016)+(5.019), (I-749)+(3.016)+(6.002), (I-749)+(3.016)+(7.001), (I-749)+(3.016)+(7.005), (I-749)+(3.016)+(9.002), (I-749)+(3.016)+(9.004), (I-749)+(3.016)+(14.001), (I-749)+(3.016)+(14.002), (I-749)+(3.016)+(15.008), (I-749)+(3.016)+(15.011), (I-749)+(3.016)+(15.012), (I-749)+(3.016)+(15.016), (I-749)+(3.016)+(15.025), (I-749)+(3.016)+(15.027), (I-749)+(3.016)+(15.047), (I-749)+(3.016)+(15.063), (I-749)+(3.016)+(15.064), (I-749)+(3.016)+(16.001), (I-749)+(3.016)+(16.005), (I-749)+(3.016)+(17.001), (I-749)+(3.016)+(17.002), (I-749)+(3.016)+(17.003), (I-749)+(3.016)+(17.008), (I-749)+(3.016)+(18.001),

(I-749)+(3.017)+(3.025), (I-749)+(3.017)+(3.030), (I-749)+(3.017)+(3.031), (I-749)+(3.017)+(5.003), (I-749)+(3.017)+(5.004), (I-749)+(3.017)+(5.005), (I-749)+(3.017)+(5.008), (I-749)+(3.017)+(5.009), (I-749)+(3.017)+(5.011), (I-749)+(3.017)+(5.012), (I-749)+(3.017)+(5.013), (I-749)+(3.017)+(5.015), (I-749)+(3.017)+(5.018), (I-749)+(3.017)+(5.019), (I-749)+(3.017)+(6.002), (I-749)+(3.017)+(7.001), (I-749)+(3.017)+(7.005), (I-749)+(3.017)+(9.002), (I-749)+(3.017)+(9.004), (I-749)+(3.017)+(14.001), (I-749)+(3.017)+(14.002), (I-749)+(3.017)+(15.008), (I-749)+(3.017)+(15.011), (I-749)+(3.017)+(15.012), (I-749)+(3.017)+(15.016), (I-749)+(3.017)+(15.025), (I-749)+(3.017)+(15.027), (I-749)+(3.017)+(15.047), (I-749)+(3.017)+(15.063), (I-749)+(3.017)+(15.064), (I-749)+(3.017)+(16.001), (I-749)+(3.017)+(16.005), (I-749)+(3.017)+(17.001), (I-749)+(3.017)+(17.002), (I-749)+(3.017)+(17.003), (I-749)+(3.017)+(17.008), (I-749)+(3.017)+(18.001),

(I-749)+(3.020)+(3.025), (I-749)+(3.020)+(3.030), (I-749)+(3.020)+(3.031), (I-749)+(3.020)+(5.003), (I-749)+(3.020)+(5.004), (I-749)+(3.020)+(5.005), (I-749)+(3.020)+(5.008), (I-749)+(3.020)+(5.009), (I-749)+(3.020)+(5.011), (I-749)+(3.020)+(5.012), (I-749)+(3.020)+(5.013), (I-749)+(3.020)+(5.015), (I-749)+(3.020)+(5.018), (I-749)+(3.020)+(5.019), (I-749)+(3.020)+(6.002), (I-749)+(3.020)+(7.001), (I-749)+(3.020)+(7.005), (I-749)+(3.020)+(9.002), (I-749)+(3.020)+(9.004), (I-749)+(3.020)+(14.001), (I-749)+(3.020)+(14.002), (I-749)+(3.020)+(15.008), (I-749)+(3.020)+(15.011), (I-749)+(3.020)+(15.012), (I-749)+(3.020)+(15.016), (I-749)+(3.020)+(15.025), (I-749)+(3.020)+(15.027), (I-749)+(3.020)+(15.047), (I-749)+(3.020)+(15.063), (I-749)+(3.020)+(15.064), (I-749)+(3.020)+(16.001), (I-749)+(3.020)+(16.005), (I-749)+(3.020)+(17.001), (I-749)+(3.020)+(17.002), (I-749)+(3.020)+(17.003), (I-749)+(3.020)+(17.008), (I-749)+(3.020)+(18.001),

(I-749)+(3.025)+(3.030), (I-749)+(3.025)+(3.031), (I-749)+(3.025)+(5.003), (I-749)+(3.025)+(5.004), (I-749)+(3.025)+(5.005), (I-749)+(3.025)+(5.008), (I-749)+(3.025)+(5.009), (I-749)+(3.025)+(5.011), (I-749)+(3.025)+(5.012), (I-749)+(3.025)+(5.013), (I-749)+(3.025)+(5.015), (I-749)+(3.025)+(5.018), (I-749)+(3.025)+(5.019), (I-749)+(3.025)+(6.002), (I-749)+(3.025)+(7.001), (I-749)+(3.025)+(7.005), (I-749)+(3.025)+(9.002), (I-749)+(3.025)+(9.004), (I-749)+(3.025)+(14.001), (I-749)+(3.025)+(14.002), (I-749)+(3.025)+(15.008), (I-749)+(3.025)+(15.011), (I-749)+(3.025)+(15.012), (I-749)+(3.025)+(15.016), (I-749)+(3.025)+(15.025), (I-749)+(3.025)+(15.027), (I-749)+(3.025)+(15.047), (I-749)+(3.025)+(15.063), (I-749)+(3.025)+(15.064), (I-749)+(3.025)+(16.001), (I-749)+(3.025)+(16.005), (I-749)+(3.025)+(17.001), (I-749)+(3.025)+(17.002), (I-749)+(3.025)+(17.003), (I-749)+(3.025)+(17.008), (I-749)+(3.025)+(18.001),

(I-749)+(3.026)+(3.025), (I-749)+(3.026)+(3.030), (I-749)+(3.026)+(3.031), (I-749)+(3.026)+(5.003), (I-749)+(3.026)+(5.004), (I-749)+(3.026)+(5.005), (I-749)+(3.026)+(5.008), (I-749)+(3.026)+(5.009), (I-749)+(3.026)+(5.011), (I-749)+(3.026)+(5.012), (I-749)+(3.026)+(5.013), (I-749)+(3.026)+(5.015), (I-749)+(3.026)+(5.018), (I-749)+(3.026)+(5.019), (I-749)+(3.026)+(6.002), (I-749)+(3.026)+(7.001), (I-749)+(3.026)+(7.005), (I-749)+(3.026)+(9.002), (I-749)+(3.026)+(9.004), (I-749)+(3.026)+(14.001), (I-749)+(3.026)+(14.002), (I-749)+(3.026)+(15.008), (I-749)+(3.026)+(15.011), (I-749)+(3.026)+(15.012), (I-749)+(3.026)+(15.016), (I-749)+(3.026)+(15.025), (I-749)+(3.026)+(15.027), (I-749)+(3.026)+(15.047), (I-749)+(3.026)+(15.063), (I-749)+(3.026)+(15.064), (I-749)+(3.026)+(16.001), (I-749)+(3.026)+(16.005), (I-749)+(3.026)+(17.001), (I-749)+(3.026)+(17.002), (I-749)+(3.026)+(17.003), (I-749)+(3.026)+(17.008), (I-749)+(3.026)+(18.001),

(I-749)+(3.030)+(3.025), (I-749)+(3.030)+(3.031), (I-749)+(3.030)+(5.003), (I-749)+(3.030)+(5.004), (I-749)+(3.030)+(5.005), (I-749)+(3.030)+(5.008), (I-749)+(3.030)+(5.009), (I-749)+(3.030)+(5.011), (I-749)+(3.030)+(5.012), (I-749)+(3.030)+(5.013), (I-749)+(3.030)+(5.015), (I-749)+(3.030)+(5.018), (I-749)+(3.030)+(5.019), (I-749)+(3.030)+(6.002), (I-749)+(3.030)+(7.001), (I-749)+(3.030)+(7.005), (I-749)+(3.030)+(9.002), (I-749)+(3.030)+(9.004), (I-749)+(3.030)+(14.001), (I-749)+(3.030)+(14.002), (I-749)+(3.030)+(15.008), (I-749)+(3.030)+(15.011), (I-749)+(3.030)+(15.012), (I-749)+(3.030)+(15.016), (I-749)+(3.030)+(15.025), (I-749)+(3.030)+(15.027), (I-749)+(3.030)+(15.047), (I-749)+(3.030)+(15.063), (I-749)+(3.030)+(15.064), (I-749)+(3.030)+(16.001), (I-749)+(3.030)+(16.005), (I-749)+(3.030)+(17.001), (I-749)+(3.030)+(17.002), (I-749)+(3.030)+(17.003), (I-749)+(3.030)+(17.008), (I-749)+(3.030)+(18.001),

(I-749)+(3.031)+(3.025), (I-749)+(3.031)+(3.030), (I-749)+(3.031)+(5.003), (I-749)+(3.031)+(5.004), (I-749)+(3.031)+(5.005), (I-749)+(3.031)+(5.008), (I-749)+(3.031)+(5.009), (I-749)+(3.031)+(5.011), (I-749)+(3.031)+(5.012), (I-749)+(3.031)+(5.013), (I-749)+(3.031)+(5.015), (I-749)+(3.031)+(5.018), (I-749)+(3.031)+(5.019), (I-749)+(3.031)+(6.002), (I-749)+(3.031)+(7.001), (I-749)+(3.031)+(7.005), (I-749)+(3.031)+(9.002), (I-749)+(3.031)+(9.004), (I-749)+(3.031)+(14.001), (I-749)+(3.031)+(14.002), (I-749)+(3.031)+(15.008), (I-749)+(3.031)+(15.011), (I-749)+(3.031)+(15.012), (I-749)+(3.031)+(15.016), (I-749)+(3.031)+(15.025), (I-749)+(3.031)+(15.027), (I-749)+(3.031)+(15.047), (I-749)+(3.031)+(15.063), (I-749)+(3.031)+(15.064), (I-749)+(3.031)+(16.001), (I-749)+(3.031)+(16.005), (I-749)+(3.031)+(17.001), (I-749)+(3.031)+(17.002), (I-749)+(3.031)+(17.003), (I-749)+(3.031)+(17.008), (I-749)+(3.031)+(18.001),

(I-749)+(5.003)+(9.002), (I-749)+(5.003)+(15.012), (I-749)+(5.003)+(15.016), (I-749)+(5.003)+(15.025), (I-749)+(5.003)+(15.027), (I-749)+(5.003)+(15.047), (I-749)+(5.003)+(15.063), (I-749)+(5.003)+(15.064),

(I-749)+(5.004)+(9.002), (I-749)+(5.004)+(15.012), (I-749)+(5.004)+(15.016), (I-749)+(5.004)+(15.025), (I-749)+(5.004)+(15.027), (I-749)+(5.004)+(15.047), (I-749)+(5.004)+(15.063), (I-749)+(5.004)+(15.064),

(I-749)+(5.005)+(9.002), (I-749)+(5.005)+(15.012), (I-749)+(5.005)+(15.016), (I-749)+(5.005)+(15.025), (I-749)+(5.005)+(15.027), (I-749)+(5.005)+(15.047), (I-749)+(5.005)+(15.063), (I-749)+(5.005)+(15.064),

(I-749)+(5.008)+(9.002), (I-749)+(5.008)+(15.012), (I-749)+(5.008)+(15.016), (I-749)+(5.008)+(15.025), (I-749)+(5.008)+(15.027), (I-749)+(5.008)+(15.047), (I-749)+(5.008)+(15.063), (I-749)+(5.008)+(15.064),

(I-749)+(5.009)+(9.002), (I-749)+(5.009)+(15.012), (I-749)+(5.009)+(15.016), (I-749)+(5.009)+(15.025), (I-749)+(5.009)+(15.027), (I-749)+(5.009)+(15.047), (I-749)+(5.009)+(15.063), (I-749)+(5.009)+(15.064),

(I-749)+(5.011)+(9.002), (I-749)+(5.011)+(15.012), (I-749)+(5.011)+(15.016), (I-749)+(5.011)+(15.025), (I-749)+(5.011)+(15.027), (I-749)+(5.011)+(15.047), (I-749)+(5.011)+(15.063), (I-749)+(5.011)+(15.064),

(I-749)+(5.012)+(9.002), (I-749)+(5.012)+(15.012), (I-749)+(5.012)+(15.016), (I-749)+(5.012)+(15.025), (I-749)+(5.012)+(15.027), (I-749)+(5.012)+(15.047), (I-749)+(5.012)+(15.063), (I-749)+(5.012)+(15.064),

(I-749)+(5.013)+(9.002), (I-749)+(5.013)+(15.012), (I-749)+(5.013)+(15.016), (I-749)+(5.013)+(15.025), (I-749)+(5.013)+(15.027), (I-749)+(5.013)+(15.047), (I-749)+(5.013)+(15.063), (I-749)+(5.013)+(15.064),

(I-749)+(5.015)+(9.002), (I-749)+(5.015)+(15.012), (I-749)+(5.015)+(15.016), (I-749)+(5.015)+(15.025), (I-749)+(5.015)+(15.027), (I-749)+(5.015)+(15.047), (I-749)+(5.015)+(15.063), (I-749)+(5.015)+(15.064),

(I-749)+(5.018)+(9.002), (I-749)+(5.018)+(15.012), (I-749)+(5.018)+(15.016), (I-749)+(5.018)+(15.025), (I-749)+(5.018)+(15.027), (I-749)+(5.018)+(15.047), (I-749)+(5.018)+(15.063), (I-749)+(5.018)+(15.064),

(I-749)+(5.019)+(9.002), (I-749)+(5.019)+(15.012), (I-749)+(5.019)+(15.016), (I-749)+(5.019)+(15.025), (I-749)+(5.019)+(15.027), (I-749)+(5.019)+(15.047), (I-749)+(5.019)+(15.063), (I-749)+(5.019)+(15.064).

According to the invention, the expression “combination” stands for the various combinations of compounds (A) and (B), for example in a single “ready-mix” form, in a combined spray mixture composed from separate formulations of the single active compounds, such as a “tank-mix”, and in a combined use of the single active ingredients when applied in a sequential manner, i.e. one after the other within a reasonably short period, such as a few hours or days. Preferably the order of applying the compounds (A) and (B) is not essential for working the present invention.

In the combinations according to the invention the compounds (A) and (B) can be present in a broad range of effective weight ratio of A:B, for example in a range of 50000:1 to 1:50000, preferably in a range of 10000:1 to 1:10000, more preferably in a weight ratio of 1000:1 to 1:1000, even more preferably in a weight ratio of 500:1 to 1:500, and most preferably in a weight ratio of 100:1 to 1:100.

Further ratios of A:B which can be used according to the present invention are: 95:1 to 1:95, 90:1 to 1:90, 85:1 to 1:85, 80:1 to 1:80, 75:1 to 1:75, 70:1 to 1:70, 65:1 to 1:65, 60:1 to 1:60, 55:1 to 1:55, 50:1 to 1:50, 45:1 to 1:45, 40:1 to 1:40, 35:1 to 1:35, 30:1 to 1:30, 25:1 to 1:25, 20:1 to 1:20, 15:1 to 1:15, 10:1 to 1:10, 5:1 to 1:5, 4:1 to 1:4, 3:1 to 1:3, 2:1 to 1:2.

Further ratios of A:B which can be used according to the present invention are: 1000:1 to 1:1, 500:1 to 1:1, 250:1 to 1:1, 100:1 to 1:1, 95:1 to 1:1, 90:1 to 1:1, 85:1 to 1:1, 80:1 to 1:1, 75:1 to 1:1, 70:1 to 1:1, 65:1 to 1:1, 60:1 to 1:1, 55:1 to 1:1, 50:1 to 1:1, 45:1 to 1:1, 40:1 to 1:1, 35:1 to 1:1, 30:1 to 1:1, 25:1 to 1:1, 20:1 to 1:1, 15:1 to 1:1, 10:1 to 1:1, 5:1 to 1:1, 4:1 to 1:1, 3:1 to 1:1, 2:1 to 1:1.

Further ratios of A:B which can be used according to the present invention are: 1:1 to 1:50000, 1:1 to 1:10000, 1:1 to 1:1000, 1:1 to 1:500, 1:1 to 1:250, 1:1 to 1:100, 1:1 to 1:95, 1:1 to 1:90, 1:1 to 1:85, 1:1 to 1:80, 1:1 to 1:75, 1:1 to 1:70, 1:1 to 1:65, 1:1 to 1:60, 1:1 to 1:55, 1:1 to 1:50, 1:1 to 1:45, 1:1 to 1:40, 1:1 to 1:35, 1:1 to 1:30, 1:1 to 1:25, 1:1 to 1:20, 1:1 to 1:15, 1:1 to 1:10, 1:1 to 1:5, 1:1 to 1:4, 1:1 to 1:3, 1:1 to 1:2.

If more than one, e.g. 2 or 3, compounds (B) are present, the weight ratio refers to the total amount of compound (B), i.e. to the sum of the amount of each compound (B) present in the combination. This applies mutatis mutandis if more than one, e.g. 2 or 3, compounds (A) are present.

If more than one, e.g. 2 or 3, compounds (B) are present in the combinations according to the invention the individual compounds (B) can be present in a broad range of effective weight ratio. If for example 2 compounds (B) are present, which are in the following referred to as compounds (B1) and (B2) the effective weight ratio of B1:B2, can vary for example in a range of 100:1 to 1:100, preferably in a weight ratio of 50:1 to 1:50, most preferably in a weight ratio of 20:1 to 1:20. Further ratios of B1:B2 which can be used according to the present invention with increasing preference in the order given are: 95:1 to 1:95, 90:1 to 1:90, 85:1 to 1:85, 80:1 to 1:80, 75:1 to 1:75, 70:1 to 1:70, 65:1 to 1:65, 60:1 to 1:60, 55:1 to 1:55, 50:1 to 1:50, 45:1 to 1:45, 40:1 to 1:40, 35:1 to 1:35, 30:1 to 1:30, 25:1 to 1:25, 15:1 to 1:15, 10:1 to 1:10, 5:1 to 1:5, 4:1 to 1:4, 3:1 to 1:3, 2:1 to 1:2.

Further ratios of B1:B2 which can be used according to the present invention are: 95:1 to 1:1, 90:1 to 1:1, 85:1 to 1:1, 80:1 to 1:1, 75:1 to 1:1, 70:1 to 1:1, 65:1 to 1:1, 60:1 to 1:1, 55:1 to 1:1, 50:1 to 1:1, 45:1 to 1:1, 40:1 to 1:1, 35:1 to 1:1, 30:1 to 1:1, 25:1 to 1:1, 20:1 to 1:1, 15:1 to 1:1, 10:1 to 1:1, 5:1 to 1:1, 4:1 to 1:1, 3:1 to 1:1, 2:1 to 1:1.

Further ratios of B1:B2 which can be used according to the present invention are: 1:1 to 1:95, 1:1 to 1:90, 1:1 to 1:85, 1:1 to 1:80, 1:1 to 1:75, 1:1 to 1:70, 1:1 to 1:65, 1:1 to 1:60, 1:1 to 1:55, 1:1 to 1:50, 1:1 to 1:45, 1:1 to 1:40, 1:1 to 1:35, 1:1 to 1:30, 1:1 to 1:25, 1:1 to 1:20, 1:1 to 1:15, 1:1 to 1:10, 1:1 to 1:5, 1:1 to 1:4, 1:1 to 1:3, 1:1 to 1:2.

Isomers

Depending on the nature of the substituents of compound (A) and the nature of compound (B), those compounds may be present in the compound combinations of the invention in the form of different stereoisomers. These stereoisomers are, for example, enantiomers, diastereomers, atropisomers or geometric isomers. Accordingly, the invention encompasses both pure stereoisomers and any mixture of these isomers. Where a compound can be present in two or more tautomer forms in equilibrium, reference to the compound by means of one tautomeric description is to be considered to include all tautomer forms. Where a compound can be present in isomeric forms and/or tautomeric forms, such a compound is understood hereinabove and hereinbelow also to include, where applicable, corresponding isomeric and/or tautomeric forms or mixtures thereof, even when these are not specifically mentioned in each case.

Salts/N-Oxides

The compounds present in the compound combination of the invention may independently of one another be present in the form of the free compound and/or, if applicable, an agrochemically active salt and/or a N-oxide thereof.

Agrochemically active salts include acid addition salts of inorganic and organic acids well as salts of customary bases. Examples of inorganic acids are hydrohalic acids, such as hydrogen fluoride, hydrogen chloride, hydrogen bromide and hydrogen iodide, sulfuric acid, phosphoric acid and nitric acid, and acidic salts, such as sodium bisulfate and potassium bisulfate. Useful organic acids include, for example, formic acid, carbonic acid and alkanoic acids such as acetic acid, trifluoroacetic acid, trichloroacetic acid and propionic acid, and also glycolic acid, thiocyanic acid, lactic acid, succinic acid, citric acid, benzoic acid, cinnamic acid, oxalic acid, saturated or mono- or diunsaturated fatty acids having 6 to 20 carbon atoms, alkylsulphuric monoesters, alkylsulphonic acids (sulphonic acids having straight-chain or branched alkyl radicals having 1 to 20 carbon atoms), arylsulphonic acids or aryldisulphonic acids (aromatic radicals, such as phenyl and naphthyl, which bear one or two sulphonic acid groups), alkylphosphonic acids (phosphonic acids having straight-chain or branched alkyl radicals having 1 to 20 carbon atoms), arylphosphonic acids or aryldiphosphonic acids (aromatic radicals, such as phenyl and naphthyl, which bear one or two phosphonic acid radicals), where the alkyl and aryl radicals may bear further substituents, for example p-toluenesulphonic acid, salicylic acid, p-aminosalicylic acid, 2-phenoxybenzoic acid, 2-acetoxybenzoic acid.

N-oxides of compounds present in the compound combination of the invention or intermediates thereof can be obtained in a simple manner by customary processes, for example by N-oxidation with hydrogen peroxide (H₂O₂), peracids, for example peroxy sulfuric acid or peroxy carboxylic acids, such as meta-chloroperoxybenzoic acid or peroxymonosulfuric acid (Caro's acid).

E.g. the corresponding N-oxides may be prepared starting from the respective compounds using conventional oxidation methods, e.g. by treating the compounds with an organic peracid such as metachloroperbenzoic acid (e.g. WO-A 2003/64572 or J. Med. Chem. 38 (11), 1892-1903, 1995); or with inorganic oxidizing agents such as hydrogen peroxide (e.g. J. Heterocyc. Chem. 18 (7), 1305-1308, 1981) or oxone (e.g. J. Am. Chem. Soc. 123 (25), 5962-5973, 2001). The oxidation may lead to pure mono-N-oxides or to a mixture of different N-oxides, which can be separated by conventional methods such as chromatography.

Crystalline Form

The compounds present in the compound combinations of the invention may exist in multiple crystalline and/or amorphous forms. Crystalline forms include unsolvated crystalline forms, solvates and hydrates, in each case of the individual compounds or adducts thereof.

Solvates of the compounds present in the compound combinations of the invention or their salts are stoichiometric compositions of the compounds with solvents.

Formulations

The present invention further relates to compositions for controlling unwanted microorganisms, comprising the compound combination according to the invention. The compositions may be applied to the microorganisms and/or in their habitat.

The composition comprises the compound combination of the invention and at least one agriculturally suitable auxiliary, e.g. carrier(s) and/or surfactant(s).

A carrier is a solid or liquid, natural or synthetic, organic or inorganic substance that is generally inert. The carrier generally improves the application of the compounds, for instance, to plants, plants parts or seeds. Examples of suitable solid carriers include, but are not limited to, ammonium salts, in particular ammonium sulfates, ammonium phosphates and ammonium nitrates, natural rock flours, such as kaolins, clays, talc, chalk, quartz, attapulgite, montmorillonite and diatomaceous earth, silica gel and synthetic rock flours, such as finely divided silica, alumina and silicates. Examples of typically useful solid carriers for preparing granules include, but are not limited to crushed and fractionated natural rocks such as calcite, marble, pumice, sepiolite and dolomite, synthetic granules of inorganic and organic flours and granules of organic material such as paper, sawdust, coconut shells, maize cobs and tobacco stalks. Examples of suitable liquid carriers include, but are not limited to, water, organic solvents and combinations thereof. Examples of suitable solvents include polar and nonpolar organic chemical liquids, for example from the classes of aromatic and nonaromatic hydrocarbons (such as cyclohexane, paraffins, alkylbenzenes, xylene, toluene, tetrahydronaphthalene, alkylnaphthalenes, chlorinated aromatics or chlorinated aliphatic hydrocarbons such as chlorobenzenes, chloroethylenes or methylene chloride), alcohols and polyols (which may optionally also be substituted, etherified and/or esterified, such as ethanol, propanol, butanol, benzylalcohol, cyclohexanol or glycol), ketones (such as acetone, methyl ethyl ketone, methyl isobutyl ketone or cyclohexanone), esters (including fats and oils) and (poly)ethers, unsubstituted and substituted amines, amides (such as dimethylformamide or fatty acid amides) and esters thereof, lactams (such as N-alkylpynolidones, in particular N-methylpynolidone) and lactones, sulfones and sulfoxides (such as dimethyl sulfoxide), oils of vegetable or animal origin. The carrier may also be a liquefied gaseous extender, i.e. liquid which is gaseous at standard temperature and under standard pressure, for example aerosol propellants such as halohydrocarbons, butane, propane, nitrogen and carbon dioxide.

Preferred solid carriers are selected from clays, talc and silica.

Preferred liquid carriers are selected from water, fatty acid amides and esters thereof, aromatic and nonaromatic hydrocarbons, lactams and carbonic acid esters.

The amount of carrier typically ranges from 1 to 99.99%, preferably from 5 to 99.9%, more preferably from 10 to 99.5%, and most preferably from 20 to 99% by weight of the composition.

Liquid carriers are typically present in a range of from 20 to 90%, for example 30 to 80% by weight of the composition.

Solid carriers are typically present in a range of from 0 to 50%, preferably 5 to 45%, for example 10 to 30% by weight of the composition.

If the composition comprises two or more carriers, the outlined ranges refer to the total amount of carriers.

The surfactant can be an ionic (cationic or anionic), amphoteric or non-ionic surfactant, such as ionic or non-ionic emulsifier(s), foam former(s), dispersant(s), wetting agent(s), penetration enhancer(s) and any mixtures thereof. Examples of suitable surfactants include, but are not limited to, salts of polyacrylic acid, salts of lignosulfonic acid (such as sodium lignosulfonate), salts of phenolsulfonic acid or naphthalenesulfonic acid, polycondensates of ethylene oxide and/or propylene oxide with fatty alcohols, fatty acids or fatty amines (for example, polyoxyethylene fatty acid esters such as castor oil ethoxylate, polyoxyethylene fatty alcohol ethers, for example alkylaryl polyglycol ethers), substituted phenols (preferably alkylphenols or arylphenols) and ethoxylates thereof (such as tristyrylphenol ethoxylate), salts of sulfosuccinic esters, taurine derivatives (preferably alkyl taurates), phosphoric esters of polyethoxylated alcohols or phenols, fatty esters of polyols (such a fatty acid esters of glycerol, sorbitol or sucrose), sulfates (such as alkyl sulfates and alkyl ether sulfates), sulfonates (for example, alkylsulfonates, arylsulfonates and alkylbenzene sulfonates), phosphate esters, protein hydrolysates, lignosulfite waste liquors and methylcellulose. Any reference to salts in this paragraph refers preferably to the respective alkali, alkaline earth and ammonium salts.

Preferred surfactants are selected from polyoxyethylene fatty alcohol ethers, polyoxyethylene fatty acid esters, alkylbenzene sulfonates, such as calcium dodecylbenzenesulfonate, castor oil ethoxylate, sodium lignosulfonate and arylphenol ethoxylates, such as tristyrylphenol ethoxylate.

The amount of surfactants typically ranges from 5 to 40%, for example 10 to 20%, by weight of the composition.

Further examples of suitable auxiliaries include water repellents, siccatives, binders (adhesive, tackifier, fixing agent, such as carboxymethylcellulose, natural and synthetic polymers in the form of powders, granules or latices, such as gum arabic, polyvinyl alcohol and polyvinyl acetate, natural phospholipids such as cephalins and lecithins and synthetic phospholipids, polyvinylpyrrolidone and tylose), thickeners and secondary thickeners (such as cellulose ethers, acrylic acid derivatives, xanthan gum, modified clays, e.g. the products available under the name Bentone, and finely divided silica), stabilizers (e.g. cold stabilizers, preservatives (e.g. dichlorophene and benzyl alcohol hemiformal), antioxidants, light stabilizers, in particular UV stabilizers, or other agents which improve chemical and/or physical stability), dyes or pigments (such as inorganic pigments, e.g. iron oxide, titanium oxide and Prussian Blue; organic dyes, e.g. alizarin, azo and metal phthalocyanine dyes), antifoams (e.g. silicone antifoams and magnesium stearate), antifreezes, stickers, gibberellins and processing auxiliaries, mineral and vegetable oils, perfumes, waxes, nutrients (including trace nutrients, such as salts of iron, manganese, boron, copper, cobalt, molybdenum and zinc), protective colloids, thixotropic substances, penetrants, sequestering agents and complex formers.

The choice of the auxiliaries depends on the intended mode of application of the compound combination of the invention and/or on the physical properties of the active compound(s) present in said compound combination. Furthermore, the auxiliaries may be chosen to impart particular properties (technical, physical and/or biological properties) to the compositions or use forms prepared therefrom. The choice of auxiliaries may allow customizing the compositions to specific needs.

The composition of the invention may be provided to the end user as ready-for-use formulation, i.e. the compositions may be directly applied to the plants or seeds by a suitable device, such as a spraying or dusting device. Alternatively, the compositions may be provided to the end user in the form of concentrates which have to be diluted, preferably with water, prior to use.

The composition of the invention can be prepared in conventional manners, for example by mixing the compound combination of the invention with one or more suitable auxiliaries, such as disclosed herein above.

The composition comprises a fungicidally effective amount of a compound combination of the invention. The term “effective amount” denotes an amount, which is sufficient for controlling harmful fungi on cultivated plants or in the protection of materials and which does not result in a substantial damage to the treated plants. Such an amount can vary in a broad range and is dependent on various factors, such as the fungal species to be controlled, the treated cultivated plant or material, the climatic conditions and the specific compound combination of the invention used. Usually, the composition according to the invention contains from 0.01 to 99% by weight, preferably from 0.05 to 98% by weight, more preferred from 0.1 to 95% by weight, even more preferably from 0.5 to 90% by weight, most preferably from 1 to 80% by weight of the compound combination of the invention.

The composition of the invention may be in any customary composition type, such as solutions (e.g aqueous solutions), emulsions, water- and oil-based suspensions, powders (e.g. wettable powders, soluble powders), dusts, pastes, granules (e.g. soluble granules, granules for broadcasting), suspoemulsion concentrates, natural or synthetic products impregnated with the compound combination of the invention, fertilizers and also microencapsulations in polymeric substances. The compound combination of the invention may be present in a suspended, emulsified or dissolved form. Examples of particular suitable composition types are solutions, water soluble concentrates (e.g. SL, LS), dispersible concentrates (DC), suspensions and suspension concentrates (e.g. SC, OD, OF, FS), emulsifiable concentrates (e.g. EC), emulsions (e.g. EW, EO, ES, ME, SE), capsules (e.g. CS, ZC), pastes, pastilles, wettable powders or dusts (e.g. WP, SP, WS, DP, DS), pressings (e.g. BR, TB, DT), granules (e.g. WG, SG, GR, FG, GG, MG), insecticidal articles (e.g. LN), as well as gel formulations for the treatment of plant propagation materials such as seeds (e.g. GW, GF). These and further compositions types are defined by the Food and Agriculture Organization of the United Nations (FAO). An overview is given in the “Catalogue of pesticide formulation types and international coding system”, Technical Monograph No. 2, 6th Ed. May 2008, Croplife International.

Preferably, the composition of the invention is in form of one of the following types: EC, SC, FS, SE, OD and WG, more preferred EC, SC, OD and WG.

Further details about examples of composition types and their preparation are given below. The outlined amount of compound combination of the invention refers to the total amount of compounds (A) and (B) present in the compound combination of the present invention. If two or more representatives of any further component of the composition, e.g. wetting agent, binder, are present, the outlined amounts of the respective component refers to the total amount of all representatives of said component, e.g. all wetting agents, all binders, all solvents and so on.

i) Water-Soluble Concentrates (SL, LS)

10-60% by weight of the compound combination of the invention and 5-15% by weight surfactant (e.g. polyoxyethylene fatty alcohol ether) are dissolved in such amount of water and/or water-soluble solvent (e.g. alcohols such as propylene glycol or carbonates such as propylene carbonate) to result in a total amount of 100% by weight. Before application the concentrate is diluted with water.

ii) Dispersible Concentrates (DC)

5-25% by weight of the compound combination of the invention and 1-10% by weight surfactant and/or binder (e.g. polyvinylpyrrolidone) are dissolved in such amount of organic solvent (e.g. cyclohexanone) to result in a total amount of 100% by weight. Dilution with water gives a dispersion.

iii) Emulsifiable Concentrates (EC)

15-70% by weight of the compound combination of the invention and 5-10% by weight surfactant (e.g. a mixture of calcium dodecylbenzenesulfonate and castor oil ethoxylate) are dissolved in such amount of water-insoluble organic solvent (e.g. aromatic hydrocarbon or fatty acid amide) and if needed additional water-soluble solvent to result in a total amount of 100% by weight. Dilution with water gives an emulsion.

iv) Emulsions (EW, EO, ES)

5-40% by weight of the compound combination of the invention and 1-10% by weight surfactant (e.g. a mixture of calcium dodecylbenzenesulfonate and castor oil ethoxylate) are dissolved in 20-40% by weight water-insoluble organic solvent (e.g. aromatic hydrocarbon). This mixture is added to such amount of water by means of an emulsifying machine to result in a total amount of 100% by weight. The resulting composition is a homogeneous emulsion. Before application the emulsion may be further diluted with water.

v) Suspensions and Suspension Concentrates

v-1) Water-Based (SC, FS)

In a suitable grinding equipment, e.g. an agitated ball mill, 20-60% by weight of the compound combination of the invention are comminuted with addition of 2-10% by weight surfactant (e.g. sodium lignosulfonate and polyoxyethylene fatty alcohol ether), 0.1-2% by weight thickener (e.g. xanthan gum) and water to give a fine active substance suspension. Water is added in such amount to result in a total amount of 100% by weight. Dilution with water gives a stable suspension of the active substances. For FS type compositions up to 40% by weight binder (e.g. polyvinylalcohol) is added.

v-2) Oil-Based (OD, OF)

In a suitable grinding equipment, e.g. an agitated ball mill, 20-60% by weight of the compound combination of the invention are comminuted with addition of 2-10% by weight surfactant (e.g. sodium lignosulfonate and polyoxyethylene fatty alcohol ether), 0.1-2% by weight thickener (e.g. modified clay, in particular Bentone, or silica) and an organic carrier to give a fine active substance oil suspension. The organic carrier is added in such amount to result in a total amount of 100% by weight. Dilution with water gives a stable dispersion of the active substances.

vi) Water-Dispersible Granules and Water-Soluble Granules (WG, SG)

50-80% by weight of the compound combination of the invention are ground finely with addition of surfactant (e.g. sodium lignosulfonate and polyoxyethylene fatty alcohol ether) and converted to water-dispersible or water-soluble granules by means of technical appliances (e. g. extrusion, spray tower, fluidized bed). The surfactant is used in such amount to result in a total amount of 100% by weight. Dilution with water gives a stable dispersion or solution of the active substances.

vii) Water-Dispersible Powders and Water-Soluble Powders (WP, SP, WS)

50-80% by weight of the compound combination of the invention are ground in a suitable mill, preferably a rotor-stator mill, with addition of 1-8% by weight surfactant (e.g. sodium lignosulfonate, polyoxyethylene fatty alcohol ether) and such amount of solid carrier, e.g. silica gel, to result in a total amount of 100% by weight. Dilution with water gives a stable dispersion or solution of the active substances.

viii) Gel (GW, GF)

In a suitable mill, e.g. an agitated ball mill, 5-25% by weight of the compound combination of the invention are comminuted with addition of 3-10% by weight surfactant (e.g. sodium lignosulfonate), 1-5% by weight binder (e.g. carboxymethylcellulose) and such amount of water to result in a total amount of 100% by weight. This results in a fine suspension of the active substance. Dilution with water gives a stable suspension of the active substances.

ix) Microemulsion (ME)

5-20% by weight of the compound combination of the invention are added to 5-30% by weight organic solvent blend (e.g. fatty acid dimethylamide and cyclohexanone), 10-25% by weight surfactant blend (e.g. polyoxyethylene fatty alcohol ether and arylphenol ethoxylate), and such amount of water to result in a total amount of 100% by weight. This mixture is stirred for 1 h to produce spontaneously a thermodynamically stable microemulsion.

x) Microcapsules (CS)

An oil phase comprising 5-50% by weight of the compound combination of the invention, 0-40% by weight water-insoluble organic solvent (e.g. aromatic hydrocarbon), 2-15% by weight acrylic monomers (e.g. methylmethacrylate, methacrylic acid and a di- or triacrylate) are dispersed into an aqueous solution of a protective colloid (e.g. polyvinyl alcohol). Radical polymerization initiated by a radical initiator results in the formation of poly(meth)acrylate microcapsules. Alternatively, an oil phase comprising 5-50% by weight of the compound combination of the invention, 0-40% by weight water-insoluble organic solvent (e.g. aromatic hydrocarbon), and an isocyanate monomer (e.g. diphenylmethene-4,4′-diisocyanatae) are dispersed into an aqueous solution of a protective colloid (e.g. polyvinyl alcohol). The addition of a polyamine (e.g. hexamethylenediamine) results in the formation of polyurea microcapsules. The monomers amount to 1-10% by weight of the total CS composition.

xi) Dustable Powders (DP, DS)

1-10% by weight of the compound combination of the invention are ground finely and mixed intimately with such amount of solid carrier, e.g. finely divided kaolin, to result in a total amount of 100% by weight.

xii) Granules (GR, FG)

0.5-30% by weight of the compound combination of the invention are ground finely and associated with such amount of solid carrier (e.g. silicate) to result in a total amount of 100% by weight. Granulation is achieved by extrusion, spray-drying or the fluidized bed.

xiii) Ultra-Low Volume Liquids (UL)

1-50% by weight of the compound combination of the invention are dissolved in such amount of organic solvent, e.g. aromatic hydrocarbon, to result in a total amount of 100% by weight.

The compositions types i) to xiii) may optionally comprise further auxiliaries, such as 0.1-1% by weight preservatives, 0.1-1% by weight antifoams, 0.1-1% by weight dyes and/or pigments, and 5-10% by weight antifreezes.

Further Active Ingredients

Compound combinations according to the invention can be used as such or in compositions/formulations thereof and can be mixed with further known active ingredients, for example biological control agents, bactericides, acaricides, nematicides or insecticides, in order thus to broaden, for example, the activity spectrum or to prevent development of resistance.

Useful mixing partners include, for example, insecticides, acaricides, nematicides and bactericides (see also Pesticide Manual, 14th ed.).

A mixture with other known active ingredients, such as herbicides, or with fertilizers and growth regulators, safeners and/or semiochemicals, is also possible.

“Insecticides” as well as the term “insecticidal” refers to the ability of a substance to increase mortality or inhibit growth rate of insects. As used herein, the term “insects” comprises all organisms in the class “Insecta”.

“Nematicide” and “nematicidal” refers to the ability of a substance to increase mortality or inhibit the growth rate of nematodes. In general, the term “nematode” comprises eggs, larvae, juvenile and mature forms of said organism.

“Acaricide” and “acaricidal” refers to the ability of a substance to increase mortality or inhibit growth rate of ectoparasites belonging to the class Arachnida, sub-class Acari.

As used herein, the term“biological control” is defined as control of harmful organisms such as a phytopathogenic fungi and/or insects and/or acarids and/or nematodes by the use or employment of a biological control agent.

As used herein, the term “biological control agent” is defined as an organism other than the harmful organisms and/or proteins or secondary metabolites produced by such an organism for the purpose of biological control. Mutants of the second organism shall be included within the definition of the biological control agent. The term “mutant” refers to a variant of the parental strain as well as methods for obtaining a mutant or variant in which the pesticidal activity is greater than that expressed by the parental strain.

The “parent strain” is defined herein as the original strain before mutagenesis. To obtain such mutants the parental strain may be treated with a chemical such as N-methyl-N′-nitro-N-nitrosoguanidine, ethylmethanesulfone, or by irradiation using gamma, x-ray, or UV-irradiation, or by other means well known to those skilled in the art. Known mechanisms of biological control agents comprise enteric bacteria that control root rot by out-competing fungi for space on the surface of the root. Bacterial toxins, such as antibiotics, have been used to control pathogens. The toxin can be isolated and applied directly to the plant or the bacterial species may be administered so it produces the toxin in situ.

A “variant” is a strain having all the identifying characteristics of the NRRL or ATCC Accession Numbers as indicated in this text and can be identified as having a genome that hybridizes under conditions of high stringency to the genome of the NRRL or ATCC Accession Numbers.

“Hybridization” refers to a reaction in which one or more polynucleotides react to form a complex that is stabilized via hydrogen bonding between the bases of the nucleotide residues. The hydrogen bonding may occur by Watson-Crick base pairing, Hoogstein binding, or in any other sequence-specific manner. The complex may comprise two strands forming a duplex structure, three or more strands forming a multi-stranded complex, a single self-hybridizing strand, or any combination of these. Hybridization reactions can be performed under conditions of different “stringency”. In general, a low stringency hybridization reaction is carried out at about 40° C. in 10×SSC or a solution of equivalent ionic strength/temperature. A moderate stringency hybridization is typically performed at about 50° C. in 6×SSC, and a high stringency hybridization reaction is generally performed at about 60° C. in 1×SSC.

A variant of the indicated NRRL or ATCC Accession Number may also be defined as a strain having a genomic sequence that is greater than 85%, more preferably greater than 90% or more preferably greater than 95% sequence identity to the genome of the indicated NRRL or ATCC Accession Number. A polynucleotide or polynucleotide region (or a polypeptide or polypeptide region) has a certain percentage (for example, 80%, 85%, 90%, or 95%) of “sequence identity” to another sequence means that, when aligned, that percentage of bases (or amino acids) are the same in comparing the two sequences. This alignment and the percent homology or sequence identity can be determined using software programs known in the art, for example, those described in Current Protocols in Molecular Biology (F. M. Ausubel et al., eds., 1987).

NRRL is the abbreviation for the Agricultural Research Service Culture Collection, an international depositary authority for the purposes of deposing microorganism strains under the Budapest treaty on the international recognition of the deposit of microorganisms for the purposes of patent procedure, having the address National Center for Agricultural Utilization Research, Agricultural Research service, U.S. Department of Agriculture, 1815 North university Street, Peroira, Ill. 61604 USA.

ATCC is the abbreviation for the American Type Culture Collection, an international depositary authority for the purposes of deposing microorganism strains under the Budapest treaty on the international recognition of the deposit of microorganisms for the purposes of patent procedure, having the address ATCC Patent Depository, 10801 University Blvd., Manassas, Va. 10110 USA.

Examples of biological control agents which may be combined with the compound combinations of the invention are:

(A) Antibacterial agents selected from the group of:

(A1) bacteria, such as (A1.1) Bacillus subtilis, in particular strain QST713/AQ713 (available as SERENADE OPTI or SERENADE ASO from Bayer CropScience LP, US, having NRRL Accession No. B21661 and described in U.S. Pat. No. 6,060,051); (A1.2) Bacillus amyloliquefaciens, in particular strain D747 (available as Double Nickel™ from Certis, US, having accession number FERM BP-8234 and disclosed in U.S. Pat. No. 7,094,592); (A1.3) Bacillus pumilus, in particular strain BU F-33 (having NRRL Accession No. 50185); (A1.4) Bacillus subtilis var. amyloliquefaciens strain FZB24 (available as Taegro® from Novozymes, US); (A1.5) a Paenibacillus sp. strain having Accession No. NRRL B-50972 or Accession No. NRRL B-67129 and described in International Patent Publication No. WO 2016/154297; and

(A2) fungi, such as (A2.1) Aureobasidium pullulans, in particular blastospores of strain DSM14940; (A2.2) Aureobasidium pullulans blastospores of strain DSM 14941; (A2.3) Aureobasidium pullulans, in particular mixtures of blastospores of strains DSM14940 and DSM14941;

(B) Biological fungicides selected from the group of:

(B1) bacteria, for example (B1.1) Bacillus subtilis, in particular strain QST713/AQ713 (available as SERENADE OPTI or SERENADE ASO from Bayer CropScience LP, US, having NRRL Accession No. B21661 and described in U.S. Pat. No. 6,060,051); (B1.2) Bacillus pumilus, in particular strain QST2808 (available as SONATA® from Bayer CropScience LP, US, having Accession No. NRRL B-30087 and described in U.S. Pat. No. 6,245,551); (B1.3) Bacillus pumilus, in particular strain GB34 (available as Yield Shield® from Bayer AG, DE); (B1.4) Bacillus pumilus, in particular strain BU F-33 (having NRRL Accession No. 50185); (B1.5) Bacillus amyloliquefaciens, in particular strain D747 (available as Double Nickel™ from Certis, US, having accession number FERM BP-8234 and disclosed in U.S. Pat. No. 7,094,592); (B1.6) Bacillus subtilis Y1336 (available as BIOBAC® WP from Bion-Tech, Taiwan, registered as a biological fungicide in Taiwan under Registration Nos. 4764, 5454, 5096 and 5277); (B1.7) Bacillus amyloliquefaciens strain MBI 600 (available as SUBTILEX from BASF SE); (B1.8) Bacillus subtilis strain GB03 (available as Kodiak® from Bayer AG, DE); (B1.9) Bacillus subtilis var. amyloliquefaciens strain FZB24 (available from Novozymes Biologicals Inc., Salem, Va. or Syngenta Crop Protection, LLC, Greensboro, N.C. as the fungicide TAEGRO® or TAEGRO® ECO (EPA Registration No. 70127-5); (B1.10) Bacillus mycoides, isolate J (available as BmJ TGAI or WG from Certis USA); (B1.11) Bacillus licheniformis, in particular strain SB3086 (available as EcoGuard™ Biofungicide and Green Releaf from Novozymes); (B1.12) a Paenibacillus sp. strain having Accession No. NRRL B-50972 or Accession No. NRRL B-67129 and described in International Patent Publication No. WO 2016/154297,

(C1) fatty acids or derivatives, for example (C1.1) a composition comprising one or more fatty acids or derivatives thereof selected from unsaturated and saturated C₁₂-C₂₄ fatty acids, salts thereof, esters thereof or mixtures of any of the foregoing, wherein at least 95% of said fatty acids or derivatives thereof are in the range of C₁₄ to C₂₀ (e.g. FLiPPER by AlphaBio Pesticides or Bayer AG).

In some embodiments, the biological control agent is a Bacillus subtilis or Bacillus amyloliquefaciens strain that produces a fengycin or plipastatin-type compound, an iturin-type compound, and/or a surfactin-type compound. For background, see the following review article: Ongena, M., et al., “Bacillus Lipopeptides: Versatile Weapons for Plant Disease Biocontrol,” Trends in Microbiology, Vol 16, No. 3, March 2008, pp. 115-125. Bacillus strains capable of producing lipopeptides include Bacillus subtilis QST713 (available as SERENADE OPTI or SERENADE ASO from Bayer CropScience LP, US, having NRRL Accession No. B2166 land described in U.S. Pat. No. 6,060,051), Bacillus amyloliquefaciens strain D747 (available as Double Nickel™ from Certis, US, having accession number FERM BP-8234 and disclosed in U.S. Pat. No. 7,094,592); Bacillus subtilis MBI600 (available as SUBTILEX® from Becker Underwood, US EPA Reg. No. 71840-8); Bacillus subtilis Y1336 (available as BIOBAC® WP from Bion-Tech, Taiwan, registered as a biological fungicide in Taiwan under Registration Nos. 4764, 5454, 5096 and 5277); Bacillus amyloliquefaciens, in particular strain FZB42 (available as RHIZOVITAL® from ABiTEP, DE); and Bacillus subtilis var. amyloliquefaciens FZB24 (available from Novozymes Biologicals Inc., Salem, Va. or Syngenta Crop Protection, LLC, Greensboro, N.C. as the fungicide TAEGRO® or TAEGRO® ECO (EPA Registration No. 70127-5); and

(B2) fungi, for example: (B2.1) Coniothyrium minitans, in particular strain CON/M/91-8 (Accession No. DSM-9660; e.g. Contans® from Bayer); (B2.2) Metschnikowia fructicola, in particular strain NRRL Y-30752 (e.g. Shemer®); (B2.3) Microsphaeropsis ochracea (e.g. Microx® from Prophyta); (B2.5) Trichoderma spp., including Trichoderma atroviride, strain SC1 described in International Application No. PCT/IT2008/000196); (B2.6) Trichoderma harzianum rifai strain KRL-AG2 (also known as strain T-22, /ATCC 208479, e.g. PLANTSHIELD T-22G, Rootshield®, and TurfShield from BioWorks, US); (B2.14) Gliocladium roseum, strain 321U from W.F. Stoneman Company LLC; (B2.35) Talaromyces flavus, strain V117b; (B2.36) Trichoderma asperellum, strain ICC 012 from Isagro; (B2.37) Trichoderma asperellum, strain SKT-1 (e.g. ECO-HOPE® from Kumiai Chemical Industry); (B2.38) Trichoderma atroviride, strain CNCM 1-1237 (e.g. Esquive® WP from Agrauxine, FR); (B2.39) Trichoderma atroviride, strain no. V08/002387; (B2.40) Trichoderma atroviride, strain NMI no. V08/002388; (B2.41) Trichoderma atroviride, strain NMI no. V08/002389; (B2.42) Trichoderma atroviride, strain NMI no. V08/002390; (B2.43) Trichoderma atroviride, strain LC52 (e.g. Tenet by Agrimm Technologies Limited); (B2.44) Trichoderma atroviride, strain ATCC 20476 (IMI 206040); (B2.45) Trichoderma atroviride, strain T11 (IMI352941/CECT20498); (B2.46) Trichoderma harmatum; (B2.47) Trichoderma harzianum; (B2.48) Trichoderma harzianum rifai T39 (e.g. Trichodex® from Makhteshim, US); (B2.49) Trichoderma harzianum, in particular, strain KD (e.g. Trichoplus from Biological Control Products, SA (acquired by Becker Underwood)); (B2.50) Trichoderma harzianum, strain ITEM 908 (e.g. Trianum-P from Koppert); (B2.51) Trichoderma harzianum, strain TH35 (e.g. Root-Pro by Mycontrol); (B2.52) Trichoderma virens (also known as Gliocladium virens), in particular strain GL-21 (e.g. SoilGard 12G by Certis, US); (B2.53) Trichoderma viride, strain TV1 (e.g. Trianum-P by Koppert); (B2.54) Ampelomyces quisqualis, in particular strain AQ 10 (e.g. AQ 10® by IntrachemBio Italia); (B2.56) Aureobasidium pullulans, in particular blastospores of strain DSM14940; (B2.57) Aureobasidium pullulans, in particular blastospores of strain DSM 14941; (B2.58) Aureobasidium pullulans, in particular mixtures of blastospores of strains DSM14940 and DSM 14941 (e.g. Botector® by bio-ferm, CH); (B2.64) Cladosporium cladosporioides, strain H39 (by Stichting Dienst Landbouwkundig Onderzoek); (B2.69) Gliocladium catenulatum (Synonym: Clonostachys rosea f. catenulate) strain J1446 (e.g. Prestop® by AgBio Inc. and also e.g. Primastop® by Kemira Agro Oy); (B2.70) Lecanicillium lecanii (formerly known as Verticillium lecanii) conidia of strain KV01 (e.g. Vertalec® by Koppert/Arysta); (B2.71) Penicillium vermiculatum; (B2.72) Pichia anomala, strain WRL-076 (NRRL Y-30842); (B2.75) Trichoderma atroviride, strain SKT-1 (FERM P-16510); (B2.76) Trichoderma atroviride, strain SKT-2 (FERM P-16511); (B2.77) Trichoderma atroviride, strain SKT-3 (FERM P-17021); (B2.78) Trichoderma gamsii (formerly T. viride), strain ICC080 (IMI CC 392151 CABI, e.g. BioDerma by AGROBIOSOL DE MEXICO, S.A. DE C.V.); (B2.79) Trichoderma harzianum, strain DB 103 (e.g., T-Gro 7456 by Dagutat Biolab); (B2.80) Trichoderma polysporum, strain IMI 206039 (e.g. Binab TF WP by BINAB Bio-Innovation AB, Sweden); (B2.81) Trichoderma stromaticum (e.g. Tricovab by Ceplac, Brazil); (B2.83) Ulocladium oudemansii, in particular strain HRU3 (e.g. Botry-Zen® by Botry-Zen Ltd, NZ); (B2.84) Verticillium albo-atrum (formerly V. dahliae), strain WCS850 (CBS 276.92; e.g. Dutch Trig by Tree Care Innovations); (B2.86) Verticillium chlamydosporium; (B2.87) mixtures of Trichoderma asperellum strain ICC 012 and Trichoderma gamsii strain ICC 080 (product known as e.g. BIO-TAM™ from Bayer CropScience LP, US).

Further examples of biological control agents which may be combined with the compound combination of the invention are:

bacteria selected from the group consisting of Bacillus cereus, in particular B. cereus strain CNCM 1-1562 and Bacillus firmus, strain 1-1582 (Accession number CNCM 1-1582), Bacillus subtilis strain OST 30002 (Accession No. NRRL B-50421), Bacillus thuringiensis, in particular B. thuringiensis subspecies israelensis (serotype H-14), strain AM65-52 (Accession No. ATCC 1276), B. thuringiensis subsp. aizawai, in particular strain ABTS-1857 (SD-1372), B. thuringiensis subsp. kurstaki strain HD-1, B. thuringiensis subsp. tenebrionis strain NB 176 (SD-5428), Pasteuria penetrans, Pasteuria spp. (Rotylenchulus reniformis nematode)-PR3 (Accession Number ATCC SD-5834), Streptomyces microflavus strain AQ6121 (=QRD 31.013, NRRL B-50550), and Streptomyces galbus strain AQ 6047 (Accession Number NRRL 30232);

fungi and yeasts selected from the group consisting of Beauveria bassiana, in particular strain ATCC 74040, Lecanicillium spp., in particular strain HRO LEC 12, Metarhizium anisopliae, in particular strain F52 (DSM3884 or ATCC 90448), Paecilomyces fumosoroseus (now: Isaria fumosorosea), in particular strain IFPC 200613, or strain Apopka 97 (Accession No. ATCC 20874), and Paecilomyces lilacinus, in particular P. lilacinus strain 251 (AGAL 89/030550);

viruses selected from the group consisting of Adoxophyes orana (summer fruit tortrix) granulosis virus (GV), Cydia pomonella (codling moth) granulosis virus (GV), Helicoverpa armigera (cotton bollworm) nuclear polyhedrosis virus (NPV), Spodoptera exigua (beet armyworm) mNPV, Spodoptera frugiperda (fall armyworm) mNPV, and Spodoptera littoralis (African cotton leafworm) NPV.

bacteria and fungi which can be added as ‘inoculant’ to plants or plant parts or plant organs and which, by virtue of their particular properties, promote plant growth and plant health. Examples are: Agrobacterium spp., Azorhizobium caulinodans, Azospirillum spp., Azotobacter spp., Bradyrhizobium spp., Burkholderia spp., in particular Burkholderia cepacia (formerly known as Pseudomonas cepacia), Gigaspora spp., or Gigaspora monosporum, Glomus spp., Laccaria spp., Lactobacillus buchneri, Paraglomus spp., Pisolithus tinctorus, Pseudomonas spp., Rhizobium spp., in particular Rhizobium trifolii, Rhizopogon spp., Scleroderma spp., Suillus spp., and Streptomyces spp.

plant extracts and products formed by microorganisms including proteins and secondary metabolites which can be used as biological control agents, such as Allium sativum, Artemisia absinthium, azadirachtin, Biokeeper WP, Cassia nigricans, Celastrus angulatus, Chenopodium anthelminticum, chitin, Armour-Zen, Dryopteris filix-mas, Equisetum arvense, Fortune Aza, Fungastop, Heads Up (Chenopodium quina saponin extract), Pyrethrum/Pyrethrins, Quassia amara, Quercus, Quillaja, Regalia, “Requiem™ Insecticide”, rotenone, ryania/ryanodine, Symphytum officinale, Tanacetum vulgare, thymol, Triact 70, TriCon, Tropaeulum majus, Urtica dioica, Veratrin, Viscum album, Brassicaceae extract, in particular oilseed rape powder or mustard powder

a composition comprising one or more fatty acids or derivatives thereof selected from unsaturated and saturated C₁₂-C₂₄ fatty acids, salts thereof, esters thereof or mixtures of any of the foregoing, wherein at least 95% of said fatty acids or derivatives thereof are in the range of C₁₄ to C₂₀ (e.g. FLiPPER by AlphaBio Pesticides or Bayer AG).

Examples of insecticides, acaricides and nematicides, respectively, which could be mixed with the compound combination of the invention are:

(1) Acetylcholinesterase (AChE) inhibitors, such as, for example, carbamates, for example alanycarb, aldicarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, XMC and xylylcarb; or organophosphates, for example acephate, azamethiphos, azinphos-ethyl, azinphos-methyl, cadusafos, chlorethoxyfos, chlorfenvinphos, chlormephos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothiophosphoryl) salicylate, isoxathion, malathion, mecarbam, methamidophos, methidathion, mevinphos, monocrotophos, naled, omethoate, oxydemeton-methyl, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, triclorfon and vamidothion.

(2) GABA-gated chloride channel blockers, such as, for example, cyclodiene-organochlorines, for example chlordane and endosulfan or phenylpyrazoles (fiproles), for example ethiprole and fipronil.

(3) Sodium channel modulators, such as, for example, pyrethroids, e.g. acrinathrin, allethrin, d-cis-trans allethrin, d-trans allethrin, bifenthrin, bioallethrin, bioallethrin s-cyclopentenyl isomer, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin [(1R)-trans-isomer], deltamethrin, empenthrin [(EZ)-(1R)-isomer], esfenvalerate, etofenprox, fenpropathrin, fenvalerate, flucythrinate, flumethrin, tau-fluvalinate, halfenprox, imiprothrin, kadethrin, momfluorothrin, permethrin, phenothrin [(1R)-trans-isomer], prallethrin, pyrethrins (pyrethrum), resmethrin, silafluofen, tefluthrin, tetramethrin, tetramethrin [(1R)-isomer)], tralomethrin and transfluthrin or DDT or methoxychlor.

(4) Nicotinic acetylcholine receptor (nAChR) competitive modulators, such as, for example, neonicotinoids, e.g. acetamiprid, clothianidin, dinotefuran, imidacloprid, nitenpyram, thiacloprid and thiamethoxam or nicotine or sulfoxaflor or flupyradifurone.

(5) Nicotinic acetylcholine receptor (nAChR) allosteric modulators, such as, for example, spinosyns, e.g. spinetoram and spinosad.

(6) Glutamate-gated chloride channel (GluCl) allosteric modulators, such as, for example, avermectins/milbemycins, for example abamectin, emamectin benzoate, lepimectin and milbemectin.

(7) Juvenile hormone mimics, such as, for example, juvenile hormone analogues, e.g. hydroprene, kinoprene and methoprene or fenoxycarb or pyriproxyfen.

(8) Miscellaneous non-specific (multi-site) inhibitors, such as, for example, alkyl halides, e.g. methyl bromide and other alkyl halides; or chloropicrine or sulphuryl fluoride or borax or tartar emetic or methyl isocyanate generators, e.g. diazomet and metam.

(9) Modulators of Chordotonal Organs, such as, for example pymetrozine or flonicamid.

(10) Mite growth inhibitors, such as, for example clofentezine, hexythiazox and diflovidazin or etoxazole.

(11) Microbial disruptors of the insect gut membrane, such as, for example Bacillus thuringiensis subspecies israelensis, Bacillus sphaericus, Bacillus thuringiensis subspecies aizawai, Bacillus thuringiensis subspecies kurstaki, Bacillus thuringiensis subspecies tenebrionis, and B.t. plant proteins: Cry1Ab, Cry1Ac, Cry1Fa, Cry1A.105, Cry2Ab, Vip3A, mCry3A, Cry3Ab, Cry3Bb, Cry34Ab1/35Ab1.

(12) Inhibitors of mitochondrial ATP synthase, such as, ATP disruptors such as, for example, diafenthiuron or organotin compounds, for example azocyclotin, cyhexatin and fenbutatin oxide or propargite or tetradifon.

(13) Uncouplers of oxidative phosphorylation via disruption of the proton gradient, such as, for example, chlorfenapyr, DNOC and sulfluramid.

(14) Nicotinic acetylcholine receptor channel blockers, such as, for example, bensultap, cartap hydrochloride, thiocylam, and thiosultap-sodium.

(15) Inhibitors of chitin biosynthesis, type 0, such as, for example, bistrifluron, chlorfluazuron, diflubenzuron, flucycloxuron, flufenoxuron, hexaflumuron, lufenuron, novaluron, noviflumuron, teflubenzuron and triflumuron.

(16) Inhibitors of chitin biosynthesis, type 1, for example buprofezin.

(17) Moulting disruptor (in particular for Diptera, i.e. dipterans), such as, for example, cyromazine.

(18) Ecdysone receptor agonists, such as, for example, chromafenozide, halofenozide, methoxyfenozide and tebufenozide.

(19) Octopamine receptor agonists, such as, for example, amitraz.

(20) Mitochondrial complex III electron transport inhibitors, such as, for example, hydramethylnone or acequinocyl or fluacrypyrim.

(21) Mitochondrial complex I electron transport inhibitors, such as, for example from the group of the METI acaricides, e.g. fenazaquin, fenpyroximate, pyrimidifen, pyridaben, tebufenpyrad and tolfenpyrad or rotenone (Denis).

(22) Voltage-dependent sodium channel blockers, such as, for example indoxacarb or metaflumizone.

(23) Inhibitors of acetyl CoA carboxylase, such as, for example, tetronic and tetramic acid derivatives, e.g. spirodiclofen, spiromesifen and spirotetramat.

(24) Mitochondrial complex IV electron transport inhibitors, such as, for example, phosphines, e.g. aluminium phosphide, calcium phosphide, phosphine and zinc phosphide or cyanides, e.g. calcium cyanide, potassium cyanide and sodium cyanide.

(25) Mitochondrial complex II electron transport inhibitors, such as, for example, beta-ketonitrile derivatives, e.g. cyenopyrafen and cyflumetofen and carboxanilides, such as, for example, pyflubumide.

(28) Ryanodine receptor modulators, such as, for example, diamides, e.g. chlorantraniliprole, cyantraniliprole and flubendiamide, further active compounds such as, for example, Afidopyropen, Afoxolaner, Azadirachtin, Benclothiaz,

Benzoximate, Bifenazate, Broflanilide, Bromopropylate, Chinomethionat, Chloroprallethrin, Cryolite, Cyclaniliprole, Cycloxaprid, Cyhalodiamide, Dicloromezotiaz, Dicofol, epsilon-Metofluthrin, epsilon-Momfluthrin, Flometoquin, Fluazaindolizine, Fluensulfone, Flufenerim, Flufenoxystrobin, Flufiprole, Fluhexafon, Fluopyram, Fluralaner, Fluxametamide, Fufenozide, Guadipyr, Heptafluthrin, Imidaclothiz, Iprodione, kappa-Bifenthrin, kappa-Tefluthrin, Lotilaner, Meperfluthrin, Paichongding, Pyridalyl, Pyrifluquinazon, Pyriminostrobin, Spirobudiclofen, Tetramethylfluthrin, Tetraniliprole, Tetrachlorantraniliprole, Tigolaner, Tioxazafen, Thiofluoximate, Triflumezopyrim and iodomethane; furthermore preparations based on Bacillus firmus (1-1582, BioNeem, Votivo), and also the following compounds: 1-{2-fluoro-4-methyl-5-[(2,2,2-trifluoroethyl)sulphinyl]phenyl}-3-(trifluoromethyl)-1H-1,2,4-triazole-5-amine (known from WO2006/043635) (CAS 885026-50-6), {1′-[(2E)-3-(4-chlorophenyl)prop-2-en-1-yl]-5-fluorospiro[indol-3,4′-piperidin]-1(2H)-yl}(2-chloropyridin-4-yl)methanone (known from WO2003/106457) (CAS 637360-23-7), 2-chloro-N-[2-{1-[(2E)-3-(4-chlorophenyl)prop-2-en-1-yl]piperidin-4-yl}-4-(trifluoromethyl)phenyl]isonicotinamide (known from WO2006/003494) (CAS 872999-66-1), 3-(4-chloro-2,6-dimethylphenyl)-4-hydroxy-8-methoxy-1,8-diazaspiro[4.5]dec-3-en-2-one (known from WO 2010052161) (CAS 1225292-17-0), 3-(4-chloro-2,6-dimethylphenyl)-8-methoxy-2-oxo-1,8-diazaspiro[4.5]dec-3-en-4-yl ethyl carbonate (known from EP2647626) (CAS 1440516-42-6), 4-(but-2-yn-1-yloxy)-6-(3,5-dimethylpiperidin-1-yl)-5-fluoropyrimidine (known from WO2004/099160) (CAS 792914-58-0), PF1364 (known from JP2010/018586) (CAS 1204776-60-2), N-[(2E)-1-[(6-chloropyridin-3-yl)methyl]pyridin-2(1H)-ylidene]-2,2,2-trifluoroacetamide (known from WO2012/029672) (CAS 1363400-41-2), (3E)-3-[1-[(6-chloro-3-pyridyl)methyl]-2-pyridylidene]-1,1,1-trifluoro-propan-2-one (known from WO2013/144213) (CAS 1461743-15-6), N-[3-(benzylcarbamoyl)-4-chlorophenyl]-1-methyl-3-(pentafluoroethyl)-4-(trifluoromethyl)-1H-pyrazole-5-carboxamide (known from WO2010/051926) (CAS 1226889-14-0), 5-bromo-4-chloro-N-[4-chloro-2-methyl-6-(methylcarbamoyl)phenyl]-2-(3-chloro-2-pyridyl)pyrazole-3-carboxamide (known from CN103232431) (CAS 1449220-44-3), 4-[5-(3,5-dichlorophenyl)-4,5-dihydro-5-(trifluoromethyl)-3-isoxazolyl]-2-methyl-N-(cis-1-oxido-3-thietanyl)-benzamide, 4-[5-(3,5-dichlorophenyl)-4,5-dihydro-5-(trifluoromethyl)-3-isoxazolyl]-2-methyl-N-(trans-1-oxido-3-thietanyl)-benzamide and 4-[(5S)-5-(3,5-dichlorophenyl)-4,5-dihydro-5-(trifluoromethyl)-3-isoxazolyl]-2-methyl-N-(cis-1-oxido-3-thietanyl)benzamide (known from WO 2013/050317 A1) (CAS 1332628-83-7), N-[3-chloro-1-(3-pyridinyl)-1H-pyrazol-4-yl]-N-ethyl-3-[(3, 3,3-trifluoropropyl)sulfinyl]-propanamide, (+)-N-[3-chloro-1-(3-pyridinyl)-1H-pyrazol-4-yl]-N-ethyl-3-[(3,3,3-trifluoropropyl)sulfinyl]-propanamide and (−)-N-[3-chloro-1-(3-pyridinyl)-1H-pyrazol-4-yl]-N-ethyl-3-[(3,3,3-trifluoropropyl)sulfinyl]-propanamide (known from WO 2013/162715 A2, WO 2013/162716 A2, US 2014/0213448 A1) (CAS 1477923-37-7), 5-[[(2E)-3-chloro-2-propen-1-yl]amino]-1-[2,6-dichloro-4-(trifluoromethyl)phenyl]-4-[(trifluoromethyl)sulfinyl]-1H-pyrazole-3-carbonitrile (known from CN 101337937 A) (CAS 1105672-77-2), 3-bromo-N-[4-chloro-2-methyl-6-[(methylamino)thioxomethyl]phenyl]-1-(3-chloro-2-pyridinyl)-1H-pyrazole-5-carboxamide, (Liudaibenjiaxuanan, known from CN 103109816 A) (CAS 1232543-85-9); N-[4-chloro-2-[[(1,1-dimethylethyl)amino]carbonyl]-6-methylphenyl]-1-(3-chloro-2-pyridinyl)-3-(fluoromethoxy)-1H-Pyrazole-5-carboxamide (known from WO 2012/034403 A1) (CAS 1268277-22-0), N-[2-(5-amino-1,3,4-thiadiazol-2-yl)-4-chloro-6-methylphenyl]-3-bromo-1-(3-chloro-2-pyridinyl)-1H-pyrazole-5-carboxamide (known from WO 2011/085575 A1) (CAS 1233882-22-8), 4-[3-[2,6-dichloro-4-[(3,3-dichloro-2-propen-1-yl)oxy]phenoxy]propoxy]-2-methoxy-6-(trifluoromethyl)-pyrimidine (known from CN 101337940 A) (CAS 1108184-52-6); (2E)- and 2(Z)-2-[2-(4-cyanophenyl)-1-[3-(trifluoromethyl)phenyl]ethylidene]-N-[4-(difluoromethoxy)phenyl]-hydrazinecarboxamide (known from CN 101715774 A) (CAS 1232543-85-9); 3-(2,2-dichloroethenyl)-2,2-dimethyl-4-(1H-benzimidazol-2-yl)phenyl-cyclopropanecarboxylic acid ester (known from CN 103524422 A) (CAS 1542271-46-4); (4aS)-7-chloro-2,5-dihydro-2-[[(methoxycarbonyl) [4-[(trifluoromethyl)thio]phenyl]amino]carbonyl]-indeno[1,2-e][1,3,4]oxadiazine-4a(3H)-carboxylic acid methyl ester (known from CN 102391261 A) (CAS 1370358-69-2); 6-deoxy-3-O-ethyl-2,4-di-O-methyl-, 1-[N-[4-[1-[4-(1,1,2,2,2-pentafluoroethoxy)phenyl]-1H-1,2,4-triazol-3-yl]phenyl]carbamate]-α-L-mannopyranose (known from US 2014/0275503 A1) (CAS 1181213-14-8); 8-(2-cyclopropylmethoxy-4-trifluoromethyl-phenoxy)-3-(6-trifluoromethyl-pyridazin-3-yl)-3-aza-bicyclo[3.2.1]octane (CAS 1253850-56-4), (8-anti)-8-(2-cyclopropylmethoxy-4-trifluoromethyl-phenoxy)-3-(6-trifluoromethyl-pyridazin-3-yl)-3-aza-bicyclo[3.2.1]octane (CAS 933798-27-7), (8-syn)-8-(2-cyclopropylmethoxy-4-trifluoromethyl-phenoxy)-3-(6-trifluoromethyl-pyridazin-3-yl)-3-aza-bicyclo[3.2.1]octane (known from WO 2007040280 A1, WO 2007040282 A1) (CAS 934001-66-8), N-[3-chloro-1-(3-pyridinyl)-1H-pyrazol-4-yl]-N-ethyl-3-[(3,3,3-trifluoropropyl)thio]-propanamide (known from WO 2015/058021 A1, WO 2015/058028 A1) (CAS 1477919-27-9) and N-[4-(aminothioxomethyl)-2-methyl-6-[(methylamino)carbonyl]phenyl]-3-bromo-1-(3-chloro-2-pyridinyl)-1H-pyrazole-5-carboxamide (known from CN 103265527 A) (CAS 1452877-50-7), 5-(1,3-dioxan-2-yl)-4-[[4-(trifluoromethyl)phenyl]methoxy]-pyrimidine (known from WO 2013/115391 A1) (CAS 1449021-97-9), 3-(4-chloro-2,6-dimethylphenyl)-4-hydroxy-8-methoxy-1-methyl-1,8-diazaspiro[4.5]dec-3-en-2-one (known from WO 2010/066780 A1, WO 2011/151146 A1) (CAS 1229023-34-0), 3-(4-chloro-2,6-dimethylphenyl)-8-methoxy-1-methyl-1,8-diazaspiro[4.5]decane-2,4-dione (known from WO 2014/187846 A1) (CAS 1638765-58-8), 3-(4-chloro-2, 6-dimethylphenyl)-8-methoxy-1-methyl-2-oxo-1,8-diazaspiro[4.5]dec-3-en-4-yl-carbonic acid ethyl ester (known from WO 2010/066780 A1, WO 2011151146 A1) (CAS 1229023-00-0), N-[1-[(6-chloro-3-pyridinyl)methyl]-2(1H)-pyridinylidene]-2,2,2-trifluoro-acetamide (known from DE 3639877 A1, WO 2012029672 A1) (CAS 1363400-41-2), [N(E)]-N-[1-[(6-chloro-3-pyridinyl)methyl]-2(1H)-pyridinylidene]-2,2,2-trifluoro-acetamide, (known from WO 2016005276 A1) (CAS 1689566-03-7), [N(Z)]—N-[1-[(6-chloro-3-pyridinyl)methyl]-2(1H)-pyridinylidene]-2,2,2-trifluoro-acetamide, (CAS 1702305-40-5), 3-endo-3-[2-propoxy-4-(trifluoromethyl)phenoxy]-9-[[5-(trifluoromethyl)-2-pyridinyl]oxy]-9-azabicyclo[3.3.1]nonane (known from WO 2011/105506 A1, WO 2016/133011 A1) (CAS 1332838-17-1).

Examples of safeners which could be mixed with the compound combination of the invention are, for example, benoxacor, cloquintocet (-mexyl), cyometrinil, cyprosulfamide, dichlormid, fenchlorazole (-ethyl), fenclorim, flurazole, fluxofenim, furilazole, isoxadifen (-ethyl), mefenpyr (-diethyl), naphthalic anhydride, oxabetrinil, 2-methoxy-N-(4-[(methylcarbamoyl)amino]phenyl-sulphonyl)benzamide (CAS 129531-12-0), 4-(dichloroacetyl)-1-oxa-4-azaspiro[4.5]decane (CAS 71526-07-3), 2,2,5-trimethyl-3-(dichloroacetyl)-1,3-oxazolidine (CAS 52836-31-4).

Examples of herbicides which could be mixed with the compound combination of the invention are:

Acetochlor, acifluorfen, acifluorfen-sodium, aclonifen, alachlor, allidochlor, alloxydim, alloxydim-sodium, ametryn, amicarbazone, amidochlor, amidosulfuron, 4-amino-3-chloro-5-fluoro-6-(7-fluoro-1H-indol-6-yl)pyridine-2-carboxylic acid, aminocyclopyrachlor, aminocyclopyrachlor-potassium, aminocyclo-pyrachlor-methyl, aminopyralid, amitrole, ammoniumsulfamate, anilofos, asulam, atrazine, azafenidin, azimsulfuron, beflubutamid, benazolin, benazolin-ethyl, benfluralin, benfuresate, bensulfuron, bensulfuron-methyl, bensulide, bentazone, benzobicyclon, benzofenap, bicyclopyron, bifenox, bilanafos, bilanafos-sodium, bispyribac, bispyribac-sodium, bixlozone, bromacil, bromobutide, bromofenoxim, bromoxynil, bromoxynil-butyrate, -potassium, -heptanoate, and -octanoate, busoxinone, butachlor, butafenacil, butamifos, butenachlor, butralin, butroxydim, butylate, cafenstrole, carbetamide, carfentrazone, carfentrazone-ethyl, chloramben, chlorbromuron, 1-{2-chloro-3-[(3-cyclopropyl-5-hydroxy-1-methyl-1H-pyrazol-4-yl)carbonyl]-6-(trifluormethyl)phenyl}piperidin-2-on, 4-{2-chloro-3-[(3,5-dimethyl-1H-pyrazol-1-yl)methyl]-4-(methylsulfonyl)benzoyl}-1,3-dimethyl-1H-pyrazol-5-yl-1,3-dimethyl-1H-pyrazol-4-carboxylat, chlorfenac, chlorfenac-sodium, chlorfenprop, chlorflurenol, chlorflurenol-methyl, chloridazon, chlorimuron, chlorimuron-ethyl, 2-[2-chloro-4-(methylsulfonyl)-3-(morpholin-4ylmethyl)benzoyl]-3-hydroxycyclohex-2-en-1-on, 4-{2-chloro-4-(methylsulfonyl)-3-[(2,2,2-trifluorethoxy)methyl]benzoyl}-1-ethyl-1H-pyrazol-5-yl-1,3-dimethyl-1H,pyrazol-4-carboxylat, chlorophthalim, chlorotoluron, chlorthal-dimethyl, 3-[5-chloro-4-(trifluormethyl)pyridine-2-yl]-4-hydroxy-1-methylimidazolidine-2-on, chlorsulfuron, cinidon, cinidon-ethyl, cinmethylin, cinosulfuron, clacyfos, clethodim, clodinafop, clodinafop-propargyl, clomazone, clomeprop, clopyralid, cloransulam, cloransulam-methyl, cumyluron, cyanamide, cyanazine, cycloate, cyclopyranil, cyclopyrimorate, cyclosulfamuron, cycloxydim, cyhalofop, cyhalofop-butyl, cyprazine, 2,4-D, 2,4-D-butotyl, -butyl, -dimethylammonium, -diolamin, -ethyl, -2-ethylhexyl, -isobutyl, -isooctyl, -isopropylammonium, -potassium, -triisopropanolammonium, and -trolamine, 2,4-DB, 2,4-DB-butyl, -dimethylammonium, -isooctyl, -potassium, and -sodium, daimuron (dymron), dalapon, dazomet, n-decanol, desmedipham, detosyl-pyrazolate (DTP), dicamba, dichlobenil, 2-(2,4-dichlorobenzyl)-4,4-dimethyl-1,2-oxazolidin-3-one, 2-(2,5-dichlorobenzyl)-4,4-dimethyl-1,2-oxazolidin-3-one, dichlorprop, dichlorprop-P, diclofop, diclofop-methyl, diclofop-P-methyl, diclosulam, difenzoquat, diflufenican, diflufenzopyr, diflufenzopyr-sodium, dimefuron, dimepiperate, dimethachlor, dimethametryn, dimethenamid, dimethenamid-P, 3-(2,6-dimethylphenyl)-6-[(2-hydroxy-6-oxocyclohex-1-en-1-yl)carbonyl]-1-methylchinazolin-2,4(1H,3H)-dion, 1,3-dimethyl-4-[2-(methylsulfonyl)-4-(trifluormethyl)benzoyl]-1H-pyrazol-5-yl-1,3-dimethyl-1H-pyrazol-4-carboxylat, dimetrasulfuron, dinitramine, dinoterb, diphenamid, diquat, diquat-dibromid, dithiopyr, diuron, DMPA, DNOC, endothal, EPTC, esprocarb, ethalfluralin, ethametsulfuron, ethametsulfuron-methyl, ethiozin, ethofumesate, ethoxyfen, ethoxyfen-ethyl, ethoxysulfuron, etobenzanid, ethyl-[(3-{2-chloro-4-fluoro-5-[3-methyl-2,6-dioxo-4-(trifluormethyl)-3,6-dihydropyrimidin-1(2H)-yl]phenoxy}pyridine-2-yl)oxy]acetat, F-9960, F-5231, i.e. N-{2-chloro-4-fluoro-5-[4-(3-fluoropropyl)-5-oxo-4,5-dihydro-1H-tetrazol-1-yl]phenyl}ethanesulfonamide, F-7967, i. e. 3-[7-chloro-5-fluoro-2-(trifluoromethyl)-1H-benzimidazol-4-yl]-1-methyl-6-(trifluoromethyl)pyrimidine-2,4(1H,3H)-dione, fenoxaprop, fenoxaprop-P, fenoxaprop-ethyl, fenoxaprop-P-ethyl, fenoxasulfone, fenquinotrione, fentrazamide, flamprop, flamprop-M-isopropyl, flamprop-M-methyl, flazasulfuron, florasulam, fluazifop, fluazifop-P, fluazifop-butyl, fluazifop-P-butyl, flucarbazone, flucarbazone-sodium, flucetosulfuron, fluchloralin, flufenacet, flufenpyr, flufenpyr-ethyl, flumetsulam, flumiclorac, flumiclorac-pentyl, flumioxazin, fluometuron, flurenol, flurenol-butyl, -dimethylammonium and -methyl, fluoroglycofen, fluoroglycofen-ethyl, flupropanate, flupyrsulfuron, flupyrsulfuron-methyl-sodium, fluridone, flurochloridone, fluroxypyr, fluroxypyr-meptyl, flurtamone, fluthiacet, fluthiacet-methyl, fomesafen, fomesafen-sodium, foramsulfuron, fosamine, glufosinate, glufosinate-ammonium, glufosinate-P-sodium, glufosinate-P-ammonium, glufosinate-P-sodium, glyphosate, glyphosate-ammonium, -isopropylammonium, -diammonium, -dimethylammonium, -potassium, -sodium, and -trimesium, H-9201, i.e. O-(2,4-dimethyl-6-nitrophenyl) O-ethyl isopropylphosphoramidothioate, halauxifen, halauxifen-methyl, halosafen, halosulfuron, halosulfuron-methyl, haloxyfop, haloxyfop-P, haloxyfop-ethoxyethyl, haloxyfop-P-ethoxyethyl, haloxyfop-methyl, haloxyfop-P-methyl, hexazinone, HW-02, i.e. 1-(dimethoxyphosphoryl) ethyl-(2,4-dichlorophenoxy)acetate, 4-hydroxy-1-methoxy-5-methyl-3-[4-trifluormethyl)pyridine-2-yl]imidazolidine-2-on, 4-hydroxy-1-methyl-3-[4-trifluormethyl)pyridine-2-yl]imidazolidine-2-on, (5-hydroxy-1-methyl-1H-pyrazol-4-yl)(3,3,4-trimethyl-1,1-dioxido-2,3-dihydro-1-benzothiophen-5-yl)methanon, 6-[(2-hydroxy-6-oxocyclohex-1-en-1-yl)carbonyl]-1,5-dimethyl-3-(2-methylphenyl)chinazolin-2,4(1H,3H)-dion, imazamethabenz, imazamethabenz-methyl, imazamox, imazamox-ammonium, imazapic, imazapic-ammonium, imazapyr, imazapyr-isopropylammonium, imazaquin, imazaquin-ammonium, imazethapyr, imazethapyr-immonium, imazosulfuron, indanofan, indaziflam, iodosulfuron, iodosulfuron-methyl-sodium, ioxynil, ioxynil-octanoate, -potassium and -sodium, ipfencarbazone, isoproturon, isouron, isoxaben, isoxaflutole, karbutilate, KUH-043, i.e. 3-({[5-(difluoromethyl)-1-methyl-3-(trifluoromethyl)-1H-pyrazol-4-yl]methyl}sulfonyl)-5,5-dimethyl-4,5-dihydro-1,2-oxazole, ketospiradox, lactofen, lenacil, linuron, MCPA, MCPA-butotyl, -dimethylammonium, -2-ethylhexyl, -isopropylammonium, -potassium, and -sodium, MCPB, MCPB-methyl, -ethyl, and -sodium, mecoprop, mecoprop-sodium, and -butotyl, mecoprop-P, mecoprop-P-butotyl, -dimethylammonium, -2-ethylhexyl, and -potassium, mefenacet, mefluidide, mesosulfuron, mesosulfuron-methyl, mesotrione, methabenzthiazuron, metam, metamifop, metamitron, metazachlor, metazosulfuron, methabenzthiazuron, methiopyrsulfuron, methiozolin, 2-({2-[(2-methoxyethoxy)methyl]-6-(trifluormethyl)pyridine-3-yl}carbonyl)cyclohexan-1,3-dion, methyl isothiocyanate, 1-methyl-4-[(3,3,4-trimethyl-1,1-dioxido-2,3-dihydro-1-benzothiophen-5-yl)carbonyl]-1H-pyrazol-5-ylpropan-1-sulfonat, metobromuron, metolachlor, S-metolachlor, metosulam, metoxuron, metribuzin, metsulfuron, metsulfuron-methyl, molinat, monolinuron, monosulfuron, monosulfuron-ester, MT-5950, i.e. N-(3-chloro-4-isopropylphenyl)-2-methylpentan amide, NGGC-011, napropamide, NC-310, i.e. [5-(benzyloxy)-1-methyl-1H-pyrazol-4-yl](2,4-dichlorophenyl)methanone, neburon, nicosulfuron, nonanoic acid (pelargonic acid), norflurazon, oleic acid (fatty acids), orbencarb, orthosulfamuron, oryzalin, oxadiargyl, oxadiazon, oxasulfuron, oxaziclomefon, oxyfluorfen, paraquat, paraquat dichloride, pebulate, pendimethalin, penoxsulam, pentachlorphenol, pentoxazone, pethoxamid, petroleum oils, phenmedipham, picloram, picolinafen, pinoxaden, piperophos, pretilachlor, primisulfuron, primisulfuron-methyl, prodiamine, profoxydim, prometon, prometryn, propachlor, propanil, propaquizafop, propazine, propham, propisochlor, propoxycarbazone, propoxycarbazone-sodium, propyrisulfuron, propyzamide, prosulfocarb, prosulfuron, pyraclonil, pyraflufen, pyraflufen-ethyl, pyrasulfotole, pyrazolynate (pyrazolate), pyrazosulfuron, pyrazosulfuron-ethyl, pyrazoxyfen, pyribambenz, pyribambenz-isopropyl, pyribambenz-propyl, pyribenzoxim, pyributicarb, pyridafol, pyridate, pyriftalid, pyriminobac, pyriminobac-methyl, pyrimisulfan, pyrithiobac, pyrithiobac-sodium, pyroxasulfone, pyroxsulam, quinclorac, quinmerac, quinoclamine, quizalofop, quizalofop-ethyl, quizalofop-P, quizalofop-P-ethyl, quizalofop-P-tefuryl, QYM-201, QYR-301, rimsulfuron, saflufenacil, sethoxydim, siduron, simazine, simetryn, SL-261, sulcotrion, sulfentrazone, sulfometuron, sulfometuron-methyl, sulfosulfuron, SYN-523, SYP-249, i.e. 1-ethoxy-3-methyl-1-oxobut-3-en-2-yl 5-[2-chloro-4-(trifluoromethyl)phenoxy]-2-nitrobenzoate, SYP-300, i.e. 1-[7-fluoro-3-oxo-4-(prop-2-yn-1-yl)-3,4-dihydro-2H-1,4-benzoxazin-6-yl]-3-propyl-2-thioxoimidazolidine-4,5-dione, 2,3,6-TBA, TCA (trichloroacetic acid), TCA-sodium, tebuthiuron, tefuryltrione, tembotrione, tepraloxydim, terbacil, terbucarb, terbumeton, terbuthylazin, terbutryn, tetflupyrolimet, thenylchlor, thiazopyr, thiencarbazone, thiencarbazone-methyl, thifensulfuron, thifensulfuron-methyl, thiobencarb, tiafenacil, tolpyralate, topra-mezone, tralkoxydim, triafamone, tri-allate, triasulfuron, triaziflam, tribenuron, tribenuron-methyl, triclopyr, trietazine, trifloxysulfuron, trifloxysulfuron-sodium, trifludimoxazin, trifluralin, triflusulfuron, triflusulfuron-methyl, tritosulfuron, urea sulfate, vernolate, XDE-848, ZJ-0862, i.e. 3,4-dichloro-N-{2-[(4,6-dimethoxypyrimidin-2-yl)oxy]benzyl}aniline

Examples for plant growth regulators are:

Acibenzolar, acibenzolar-S-methyl, 5-aminolevulinic acid, ancymidol, 6-benzylaminopurine, Brassinolid, catechine, chlormequat chloride, cloprop, cyclanilide, 3-(cycloprop-1-enyl) propionic acid, daminozide, dazomet, n-decanol, dikegulac, dikegulac-sodium, endothal, endothal-dipotassium, -disodium, and -mono(N,N-dimethylalkylammonium), ethephon, flumetralin, flurenol, flurenol-butyl, flurprimidol, forchlorfenuron, gibberellic acid, inabenfide, indol-3-acetic acid (IAA), 4-indol-3-ylbutyric acid, isoprothiolane, probenazole, jasmonic acid, maleic hydrazide, mepiquat chloride, 1-methylcyclopropene, methyl jasmonate, 2-(1-naphthyl)acetamide, 1-naphthylacetic acid, 2-naphthyloxyacetic acid, nitrophenolate-mixture, paclobutrazol, N-(2-phenylethyl)-beta-alanine, N-phenylphthalamic acid, prohexadione, prohexadione-calcium, prohydrojasmone, salicylic acid, strigolactone, tecnazene, thidiazuron, triacontanol, trinexapac, trinexapac-ethyl, tsitodef, uniconazole, uniconazole-P.

Methods and Uses

The compound combination and the composition of the invention have potent microbicidal activity and/or plant defense modulating potential. They can be used for controlling unwanted microorganisms, such as unwanted fungi and bacteria, on plants. They can be particularly useful in crop protection (they control microorganisms that cause plants diseases) or for protecting materials (e.g. industrial materials, timber, storage goods) as described in more details herein below. More specifically, compound combination and the composition of the invention can be used to protect seeds, germinating seeds, emerged seedlings, plants, plant parts, fruits, harvest goods and/or the soil in which the plants grow from unwanted microorganisms.

Control or controlling as used herein encompasses protective, curative and eradicative treatment of unwanted microorganisms. Unwanted microorganisms may be pathogenic bacteria, pathogenic virus, pathogenic oomycetes or pathogenic fungi, more specifically phytopathogenic bacteria, phytopathogenic virus, phytopathogenic oomycetes or phytopathogenic fungi. As detailed herein below, these phytopathogenic microorganisms are the causal agents of a broad spectrum of plants diseases.

More specifically, the compound combination and the composition of the invention can be used as fungicides. For the purpose of the specification, the term “fungicide” refers to a compound or composition that can be used in crop protection for the control of unwanted fungi, such as Plasmodiophoromycetes, Chytridiomycetes, Zygomycetes, Ascomycetes, Basidiomycetes and Deuteromycetes and/or for the control of Oomycetes.

The compound combination and the composition of the invention may also be used as antibacterial agent. In particular, they may be used in crop protection, for example for the control of unwanted bacteria, such as Pseudomonadaceae, Rhizobiaceae, Xanthomonadaceae, Enterobacteriaceae, Corynebacteriaceae and Streptomycetaceae.

The present invention also relates to a method for controlling unwanted microorganisms, such as unwanted fungi, oomycetes and bacteria, on plants comprising the step of applying the compound combination or the composition of the invention to the microorganisms and/or their habitat (to the plants, plant parts, seeds, fruits or to the soil in which the plants grow), wherein the compounds (A) and (B) may be applied in a simultaneous, separate or sequential manner. If the single compounds are applied in a sequential manner, i.e. at different times, they are applied one after the other within a reasonably short period, such as a few hours or days.

Typically, when the compound combination and the composition of the invention are used in curative or protective methods for controlling phytopathogenic fungi and/or phytopathogenic oomycetes, an effective and plant-compatible amount thereof is applied to the plants, plant parts, fruits, seeds or to the soil or substrates in which the plants grow. Suitable substrates that may be used for cultivating plants include inorganic based substrates, such as mineral wool, in particular stone wool, perlite, sand or gravel; organic substrates, such as peat, pine bark or sawdust; and petroleum based substrates such as polymeric foams or plastic beads. Effective and plant-compatible amount means an amount that is sufficient to control or destroy the fungi present or liable to appear on the cropland and that does not entail any appreciable symptom of phytotoxicity for said crops. Such an amount can vary within a wide range depending on the fungus to be controlled, the type of crop, the crop growth stage, the climatic conditions and the respective compound or composition of the invention used. This amount can be determined by systematic field trials that are within the capabilities of a person skilled in the art.

Plants and Plant Parts

The compound combination and the composition of the invention may be applied to any plants or plant parts.

Plants mean all plants and plant populations, such as desired and undesired wild plants or crop plants (including naturally occurring crop plants). Crop plants may be plants which can be obtained by conventional breeding and optimization methods or by biotechnological and genetic engineering methods or combinations of these methods, including the genetically modified plants (GMO or transgenic plants) and the plant cultivars which are protectable and non-protectable by plant breeders' rights.

Genetically Modified Plants (GMO)

Genetically modified plants (GMO or transgenic plants) are plants in which a heterologous gene has been stably integrated into the genome. The expression “heterologous gene” essentially means a gene which is provided or assembled outside the plant and when introduced in the nuclear, chloroplastic or mitochondrial genome. This gene gives the transformed plant new or improved agronomic or other properties by expressing a protein or polypeptide of interest or by downregulating or silencing other gene(s) which are present in the plant (using for example, antisense technology, cosuppression technology, RNA interference—RNAi—technology or microRNA—miRNA—technology). A heterologous gene that is located in the genome is also called a transgene. A transgene that is defined by its particular location in the plant genome is called a transformation or transgenic event.

Plant cultivars are understood to mean plants which have new properties (“traits”) and have been obtained by conventional breeding, by mutagenesis or by recombinant DNA techniques. They can be cultivars, varieties, bio- or genotypes.

Plant parts are understood to mean all parts and organs of plants above and below the ground, such as shoots, leaves, needles, stalks, stems, flowers, fruit bodies, fruits, seeds, roots, tubers and rhizomes. The plant parts also include harvested material and vegetative and generative propagation material, for example cuttings, tubers, rhizomes, slips and seeds.

Plants which may be treated in accordance with the methods of the invention include the following: cotton, flax, grapevine, fruit, vegetables, such as Rosaceae sp. (for example pome fruits such as apples and pears, but also stone fruits such as apricots, cherries, almonds and peaches, and soft fruits such as strawberries), Ribesioidae sp., Juglandaceae sp., Betulaceae sp., Anacardiaceae sp., Fagaceae sp., Moraceae sp., Oleaceae sp., Actinidaceae sp., Lauraceae sp., Musaceae sp. (for example banana trees and plantations), Rubiaceae sp. (for example coffee), Theaceae sp., Sterculiceae sp., Rutaceae sp. (for example lemons, oranges and grapefruit); Solanaceae sp. (for example tomatoes), Liliaceae sp., Asteraceae sp. (for example lettuce), Umbelliferae sp., Cruciferae sp., Chenopodiaceae sp., Cucurbitaceae sp. (for example cucumber), Alliaceae sp. (for example leek, onion), Papilionaceae sp. (for example peas); major crop plants, such as Gramineae sp. (for example maize, turf, cereals such as wheat, rye, rice, barley, oats, millet and triticale), Asteraceae sp. (for example sunflower), Brassicaceae sp. (for example white cabbage, red cabbage, broccoli, cauliflower, Brussels sprouts, pak choi, kohlrabi, radishes, and oilseed rape, mustard, horseradish and cress), Fabacae sp. (for example bean, peanuts), Papilionaceae sp. (for example soya bean), Solanaceae sp. (for example potatoes), Chenopodiaceae sp. (for example sugar beet, fodder beet, swiss chard, beetroot); useful plants and ornamental plants for gardens and wooded areas; and genetically modified varieties of each of these plants.

Plants and plant cultivars which may be treated by the above disclosed methods include plants and plant cultivars which are resistant against one or more biotic stresses, i.e. said plants show a better defense against animal and microbial pests, such as against nematodes, insects, mites, phytopathogenic fungi, bacteria, viruses and/or viroids.

Plants and plant cultivars which may be treated by the above disclosed methods include those plants which are resistant to one or more abiotic stresses. Abiotic stress conditions may include, for example, drought, cold temperature exposure, heat exposure, osmotic stress, flooding, increased soil salinity, increased mineral exposure, ozone exposure, high light exposure, limited availability of nitrogen nutrients, limited availability of phosphorus nutrients, shade avoidance.

Plants and plant cultivars which may be treated by the above disclosed methods include those plants characterized by enhanced yield characteristics. Increased yield in said plants may be the result of, for example, improved plant physiology, growth and development, such as water use efficiency, water retention efficiency, improved nitrogen use, enhanced carbon assimilation, improved photosynthesis, increased germination efficiency and accelerated maturation. Yield may furthermore be affected by improved plant architecture (under stress and non-stress conditions), including but not limited to, early flowering, flowering control for hybrid seed production, seedling vigor, plant size, internode number and distance, root growth, seed size, fruit size, pod size, pod or ear number, seed number per pod or ear, seed mass, enhanced seed filling, reduced seed dispersal, reduced pod dehiscence and lodging resistance. Further yield traits include seed composition, such as carbohydrate content and composition for example cotton or starch, protein content, oil content and composition, nutritional value, reduction in anti-nutritional compounds, improved processability and better storage stability.

Plants and plant cultivars which may be treated by the above disclosed methods include plants and plant cultivars which are hybrid plants that already express the characteristic of heterosis or hybrid vigor which results in generally higher yield, vigor, health and resistance towards biotic and abiotic stresses.

Plants and plant cultivars (obtained by plant biotechnology methods such as genetic engineering) which may be treated by the above disclosed methods include plants and plant cultivars which are herbicide-tolerant plants, i.e. plants made tolerant to one or more given herbicides. Such plants can be obtained either by genetic transformation, or by selection of plants containing a mutation imparting such herbicide tolerance.

Plants and plant cultivars (obtained by plant biotechnology methods such as genetic engineering) which may be treated by the above disclosed methods include plants and plant cultivars which are insect-resistant transgenic plants, i.e. plants made resistant to attack by certain target insects. Such plants can be obtained by genetic transformation, or by selection of plants containing a mutation imparting such insect resistance.

Plants and plant cultivars (obtained by plant biotechnology methods such as genetic engineering) which may be treated by the above disclosed methods include plants and plant cultivars which are disease-resistant transgenic plants, i.e. plants made resistant to attack by certain target insects. Such plants can be obtained by genetic transformation, or by selection of plants containing a mutation imparting such insect resistance.

Plants and plant cultivars (obtained by plant biotechnology methods such as genetic engineering) which may be treated by the above disclosed methods include plants and plant cultivars which are tolerant to abiotic stresses. Such plants can be obtained by genetic transformation, or by selection of plants containing a mutation imparting such stress resistance.

Plants and plant cultivars (obtained by plant biotechnology methods such as genetic engineering) which may be treated by the above disclosed methods include plants and plant cultivars which show altered quantity, quality and/or storage-stability of the harvested product and/or altered properties of specific ingredients of the harvested product.

Plants and plant cultivars (obtained by plant biotechnology methods such as genetic engineering) which may be treated by the above disclosed methods include plants and plant cultivars, such as cotton plants, with altered fiber characteristics. Such plants can be obtained by genetic transformation, or by selection of plants contain a mutation imparting such altered fiber characteristics.

Plants and plant cultivars (obtained by plant biotechnology methods such as genetic engineering) which may be treated by the above disclosed methods include plants and plant cultivars, such as oilseed rape or related Brassica plants, with altered oil profile characteristics. Such plants can be obtained by genetic transformation, or by selection of plants contain a mutation imparting such altered oil profile characteristics.

Plants and plant cultivars (obtained by plant biotechnology methods such as genetic engineering) which may be treated by the above disclosed methods include plants and plant cultivars, such as oilseed rape or related Brassica plants, with altered seed shattering characteristics. Such plants can be obtained by genetic transformation, or by selection of plants contain a mutation imparting such altered seed shattering characteristics and include plants such as oilseed rape plants with delayed or reduced seed shattering.

Plants and plant cultivars (obtained by plant biotechnology methods such as genetic engineering) which may be treated by the above disclosed methods include plants and plant cultivars, such as Tobacco plants, with altered post-translational protein modification patterns.

Pathogens

Non-limiting examples of pathogens of fungal diseases which may be treated in accordance with the invention include:

diseases caused by powdery mildew pathogens, for example Blumeria species, for example Blumeria graminis; Podosphaera species, for example Podosphaera leucotricha; Sphaerotheca species, for example Sphaerotheca fuliginea; Uncinula species, for example Uncinula necator;

diseases caused by rust disease pathogens, for example Gymnosporangium species, for example Gymnosporangium sabinae; Hemileia species, for example Hemileia vastatrix; Phakopsora species, for example Phakopsora pachyrhizi or Phakopsora meibomiae; Puccinia species, for example Puccinia recondita, Puccinia graminis oder Puccinia striiformis; Uromyces species, for example Uromyces appendiculatus;

diseases caused by pathogens from the group of the Oomycetes, for example Albugo species, for example Albugo candida; Bremia species, for example Bremia lactucae; Peronospora species, for example Peronospora pisi or P. brassicae; Phytophthora species, for example Phytophthora infestans; Plasmopara species, for example Plasmopara viticola; Pseudoperonospora species, for example Pseudoperonospora humuli or Pseudoperonospora cubensis; Pythium species, for example Pythium ultimum;

leaf blotch diseases and leaf wilt diseases caused, for example, by Alternaria species, for example Alternaria solani and Alternaria alternate; Cercospora species, for example Cercospora beticola; Cladiosporium species, for example Cladiosporium cucumerinum; Cochliobolus species, for example Cochliobolus sativus (conidial form: Drechslera, syn: Helminthosporium) or Cochliobolus miyabeanus; Colletotrichum species, for example Colletotrichum lindemuthanium; Cordana species, for example Cordana musae; Corynespora species, for example Corynespora cassiicola; Cycloconium species, for example Cycloconium oleaginum; Diaporthe species, for example Diaporthe citri; Elsinoe species, for example Elsinoe fawcettii; Gloeosporium species, for example Gloeosporium laeticolor; Glomerella species, for example Glomerella cingulata; Guignardia species, for example Guignardia bidwelli; Leptosphaeria species, for example Leptosphaeria macularis; Magnaporthe species, for example Magnaporthe grisea; Microdochium species, for example Microdochium nivale; Mycosphaerella species, for example Mycosphaerella graminicola, Mycosphaerella arachidicola or Mycosphaerella fijiensis; Parastagonospora species, for example Parastagonospora nodorum; Phaeosphaeria species, for example Phaeosphaeria nodorum; Pyrenophora species, for example Pyrenophora teres or Pyrenophora tritici repentis; Ramularia species, for example Ramularia collo-cygni or Ramularia areola; Rhynchosporium species, for example Rhynchosporium secalis; Septoria species, for example Septoria apii or Septoria lycopersici; Stagonospora species, for example Stagonospora nodorum; Typhula species, for example Typhula incamata; Ustilago species, for example Ustilago segetum; Venturia species, for example Venturia inaequalis;

root and stem diseases caused, for example, by Corticium species, for example Corticium graminearum; Fusarium species, for example Fusarium oxysporum; Gaeumannomyces species, for example Gaeumannomyces graminis; Plasmodiophora species, for example Plasmodiophora brassicae; Rhizoctonia species, for example Rhizoctonia solani; Sarocladium species, for example Sarocladium oryzae; Sclerotium species, for example Sclerotium oryzae; Tapesia species, for example Tapesia acuformis; Thielaviopsis species, for example Thielaviopsis basicola;

ear and panicle diseases (including corn cobs) caused, for example, by Alternaria species, for example Alternaria spp.; Aspergillus species, for example Aspergillus flavus; Cladosporium species, for example Cladosporium cladosporioides; Claviceps species, for example Claviceps purpurea; Fusarium species, for example Fusarium culmorum; Gibberella species, for example Gibberella zeae; Monographella species, for example Monographella nivalis; Stagnospora species, for example Stagnospora nodorum;

diseases caused by smut fungi, for example Sphacelotheca species, for example Sphacelotheca reiliana; Tilletia species, for example Tilletia caries or Tilletia controversa; Urocystis species, for example Urocystis occulta; Ustilago species, for example Ustilago cauda;

fruit rot caused, for example, by Aspergillus species, for example Aspergillus flavus; Botrytis species, for example Botrytis cinerea; Monilinia species, for example Monilinia laxa; Penicillium species, for example Penicillium expansum or Penicillium purpurogenum; Rhizopus species, for example Rhizopus stolonifer; Sclerotinia species, for example Sclerotinia sclerotiorum; Verticilium species, for example Verticilium alboatrum;

seed- and soil-borne rot and wilt diseases, and also diseases of seedlings, caused, for example, by Alternaria species, for example Alternaria brassicicola; Aphanomyces species, for example Aphanomyces euteiches; Ascochyta species, for example Ascochyta lentis; Aspergillus species, for example Aspergillus flavus; Cladosporium species, for example Cladosporium herbarum; Cochliobolus species, for example Cochliobolus sativus (conidial form: Drechslera, Bipolaris Syn: Helminthosporium); Colletotrichum species, for example Colletotrichum coccodes; Fusarium species, for example Fusarium culmorum; Gibberella species, for example Gibberella zeae; Macrophomina species, for example Macrophomina phaseolina; Microdochium species, for example Microdochium nivale; Monographella species, for example Monographella nivalis; Penicillium species, for example Penicillium expansum; Phoma species, for example Phoma lingam; Phomopsis species, for example Phomopsis sojae; Phytophthora species, for example Phytophthora cactorum; Pyrenophora species, for example Pyrenophora graminea; Pyricularia species, for example Pyricularia oryzae; Pythium species, for example Pythium ultimum; Rhizoctonia species, for example Rhizoctonia solani; Rhizopus species, for example Rhizopus oryzae; Sclerotium species, for example Sclerotium rolfsii; Septoria species, for example Septoria nodorum; Typhula species, for example Typhula incamata; Verticillium species, for example Verticillium dahliae;

cancers, galls and witches' broom caused, for example, by Nectria species, for example Nectria galligena;

wilt diseases caused, for example, by Verticillium species, for example Verticillium longisporum; Fusarium species, for example Fusarium oxysporum;

deformations of leaves, flowers and fruits caused, for example, by Exobasidium species, for example Exobasidium vexans; Taphrina species, for example Taphrina deformans;

degenerative diseases in woody plants, caused, for example, by Esca species, for example Phaeomoniella chlamydospora, Phaeoacremonium aleophilum or Fomitiporia mediterranea; Ganoderma species, for example Ganoderma boninense;

diseases of plant tubers caused, for example, by Rhizoctonia species, for example Rhizoctonia solani; Helminthosporium species, for example Helminthosporium solani;

diseases caused by bacterial pathogens, for example Xanthomonas species, for example Xanthomonas campestris pv. oryzae; Pseudomonas species, for example Pseudomonas syringae pv. lachrymans; Erwinia species, for example Erwinia amylovora; Liberibacter species, for example Liberibacter asiaticus; Xyella species, for example Xylella fastidiosa; Ralstonia species, for example Ralstonia solanacearum; Dickeya species, for example Dickeya solani; Clavibacter species, for example Clavibacter michiganensis; Streptomyces species, for example Streptomyces scabies.

diseases of soya beans:

Fungal diseases on leaves, stems, pods and seeds caused, for example, by Alternaria leaf spot (Alternaria spec. atrans tenuissima), Anthracnose (Colletotrichum gloeosporoides dematium var. truncatum), brown spot (Septoria glycines), cercospora leaf spot and blight (Cercospora kikuchii), choanephora leaf blight (Choanephora infundibulifera trispora (Syn.)), dactuliophora leaf spot (Dactuliophora glycines), downy mildew (Peronospora manshurica), drechslera blight (Drechslera glycini), frogeye leaf spot (Cercospora sojina), leptosphaerulina leaf spot (Leptosphaerulina trifolii), phyllostica leaf spot (Phyllosticta sojaecola), pod and stem blight (Phomopsis sojae), powdery mildew (Microsphaera diffusa), pyrenochaeta leaf spot (Pyrenochaeta glycines), rhizoctonia aerial, foliage, and web blight (Rhizoctonia solani), rust (Phakopsora pachyrhizi, Phakopsora meibomiae), scab (Sphaceloma glycines), stemphylium leaf blight (Stemphylium botryosum), sudden death syndrome (Fusarium virgulifome), target spot (Corynespora cassiicola).

Fungal diseases on roots and the stem base caused, for example, by black root rot (Calonectria crotalariae), charcoal rot (Macrophomina phaseolina), fusarium blight or wilt, root rot, and pod and collar rot (Fusarium oxysporum, Fusarium orthoceras, Fusarium semitectum, Fusarium equiseti), mycoleptodiscus root rot (Mycoleptodiscus terrestris), neocosmospora (Neocosmospora vasinfecta), pod and stem blight (Diaporthe phaseolorum), stem canker (Diaporthe phaseolorum var. caulivora), phytophthora rot (Phytophthora megasperma), brown stem rot (Phialophora gregata), pythium rot (Pythium aphanidermatum, Pythium irregulare, Pythium debaryanum, Pythium myriotylum, Pythium ultimum), rhizoctonia root rot, stem decay, and damping-off (Rhizoctonia solani), sclerotinia stem decay (Sclerotinia sclerotiorum), sclerotinia southern blight (Sclerotinia rolfsii), thielaviopsis root rot (Thielaviopsis basicola).

Mycotoxins

In addition, the compound combination and the composition of the invention may reduce the mycotoxin content in the harvested material and the foods and feeds prepared therefrom. Mycotoxins include particularly, but not exclusively, the following: deoxynivalenol (DON), nivalenol, 15-Ac-DON, 3-Ac-DON, T2- and HT2-toxin, fumonisins, zearalenon, moniliformin, fusarin, diaceotoxyscirpenol (DAS), beauvericin, enniatin, fusaroproliferin, fusarenol, ochratoxins, patulin, ergot alkaloids and aflatoxins which can be produced, for example, by the following fungi: Fusarium spec., such as F. acuminatum, F. asiaticum, F. avenaceum, F. crookwellense, F. culmorum, F. graminearum (Gibberella zeae), F. equiseti, F. fujikoroi, F. musarum, F. oxysporum, F. proliferatum, F. poae, F. pseudograminearum, F. sambucinum, F. scirpi, F. semitectum, F. solani, F. sporotrichoides, F. langsethiae, F. subglutinans, F. tricinctum, F. verticillioides, and also by Aspergillus spec., such as A. flavus, A. parasiticus, A. nomius, A. ochraceus, A. clavatus, A. terreus, A. versicolor, Penicillium spec., such as P. verrucosum, P. viridicatum, P. citrinum, P. expansum, P. claviforme, P. roqueforti, Claviceps spec., such as C. purpurea, C. fusiformis, C. paspali, C. africana, Stachybotrys spec. and others.

Material Protection

The compound combination and the composition of the invention may also be used in the protection of materials, especially for the protection of industrial materials against attack and destruction by phytopathogenic fungi.

In addition, the compound combination and the composition of the invention may be used as antifouling compositions, alone or in combinations with other active ingredients.

Industrial materials in the present context are understood to mean inanimate materials which have been prepared for use in industry. For example, industrial materials which are to be protected from microbial alteration or destruction may be adhesives, glues, paper, wallpaper and board/cardboard, textiles, carpets, leather, wood, fibers and tissues, paints and plastic articles, cooling lubricants and other materials which can be infected with or destroyed by microorganisms. Parts of production plants and buildings, for example cooling-water circuits, cooling and heating systems and ventilation and air-conditioning units, which may be impaired by the proliferation of microorganisms may also be mentioned within the scope of the materials to be protected. Industrial materials within the scope of the present invention preferably include adhesives, sizes, paper and card, leather, wood, paints, cooling lubricants and heat transfer fluids, more preferably wood.

The compound combination and the composition of the invention may prevent adverse effects, such as rotting, decay, discoloration, decoloration or formation of mould.

In the case of treatment of wood the compound combination and the composition of the invention may also be used against fungal diseases liable to grow on or inside timber.

Timber means all types of species of wood, and all types of working of this wood intended for construction, for example solid wood, high-density wood, laminated wood, and plywood. In addition, the compound and the composition of the invention may be used to protect objects which come into contact with saltwater or brackish water, especially hulls, screens, nets, buildings, moorings and signalling systems, from fouling.

The compound combination and the composition of the invention may also be employed for protecting storage goods. Storage goods are understood to mean natural substances of vegetable or animal origin or processed products thereof which are of natural origin, and for which long-term protection is desired. Storage goods of vegetable origin, for example plants or plant parts, such as stems, leaves, tubers, seeds, fruits, grains, may be protected freshly harvested or after processing by (pre)drying, moistening, comminuting, grinding, pressing or roasting. Storage goods also include timber, both unprocessed, such as construction timber, electricity poles and bathers, or in the form of finished products, such as furniture. Storage goods of animal origin are, for example, hides, leather, furs and hairs. The compound combination and the composition of the invention may prevent adverse effects, such as rotting, decay, discoloration, decoloration or formation of mould.

Microorganisms capable of degrading or altering industrial materials include, for example, bacteria, fungi, yeasts, algae and slime organisms. The compound combination and the composition of the invention preferably act against fungi, especially moulds, wood-discoloring and wood-destroying fungi (Ascomycetes, Basidiomycetes, Deuteromycetes and Zygomycetes), and against slime organisms and algae. Examples include microorganisms of the following genera: Alternaria, such as Alternaria tenuis; Aspergillus, such as Aspergillus niger; Chaetomium, such as Chaetomium globosum; Coniophora, such as Coniophora puetana; Lentinus, such as Lentinus tigrinus; Penicillium, such as Penicillium glaucum; Polyporus, such as Polyporus versicolor; Aureobasidium, such as Aureobasidium pullulans; Sclerophoma, such as Sclerophoma pityophila; Trichoderma, such as Trichoderma viride; Ophiostoma spp., Ceratocystis spp., Humicola spp., Petriella spp., Trichurus spp., Coriolus spp., Gloeophyllum spp., Pleurotus spp., Poria spp., Serpula spp. and Tyromyces spp., Cladosporium spp., Paecilomyces spp. Mucor spp., Escherichia, such as Escherichia coli; Pseudomonas, such as Pseudomonas aeruginosa; Staphylococcus, such as Staphylococcus aureus, Candida spp. and Saccharomyces spp., such as Saccharomyces cerevisae.

Seed Treatment

The compound combination and the composition of the invention may also be used to protect seeds from unwanted microorganisms, such as phytopathogenic microorganisms, for instance phytopathogenic fungi or phytopathogenic oomycetes. The term seed(s) as used herein include dormant seeds, primed seeds, pregerminated seeds and seeds with emerged roots and leaves.

Thus, the present invention also relates to a method for protecting seeds from unwanted microorganisms which comprises the step of treating the seeds with the compound combination or the composition of the invention, wherein the seeds may be treated simultaneously, separately or sequentially with the compounds (A) and (B).

The treatment of seeds with the compound combination or the composition of the invention protects the seeds from phytopathogenic microorganisms, but also protects the germinating seeds, the emerging seedlings and the plants after emergence from the treated seeds. Therefore, the present invention also relates to a method for protecting seeds, germinating seeds and emerging seedlings.

The seeds treatment may be performed prior to sowing, at the time of sowing or shortly thereafter.

When the seeds treatment is performed prior to sowing (e.g. so-called on-seed applications), the seeds treatment may be performed as follows: the seeds may be placed into a mixer with a desired amount of the compound combination or the composition of the invention, the seeds and the compound combination or the composition of the invention are mixed until an homogeneous distribution on seeds is achieved. If appropriate, the seeds may then be dried.

The invention also relates to seeds coated with the compound combination or the composition of the invention.

Preferably, the seeds are treated in a state in which it is sufficiently stable for no damage to occur in the course of treatment. In general, seeds can be treated at any time between harvest and shortly after sowing. It is customary to use seeds which have been separated from the plant and freed from cobs, shells, stalks, coats, hairs or the flesh of the fruits. For example, it is possible to use seeds which have been harvested, cleaned and dried down to a moisture content of less than 15% by weight. Alternatively, it is also possible to use seeds which, after drying, for example, have been treated with water and then dried again, or seeds just after priming, or seeds stored in primed conditions or pre-germinated seeds, or seeds sown on nursery trays, tapes or paper.

The amount of the compound combination or the composition of the invention applied to the seeds is typically such that the germination of the seed is not impaired, or that the resulting plant is not damaged. This must be ensured particularly in case the compounds contained in the compound combination of the invention would exhibit phytotoxic effects at certain application rates. The intrinsic phenotypes of transgenic plants should also be taken into consideration when determining the amount of the compound combination of the invention to be applied to the seed in order to achieve optimum seed and germinating plant protection with a minimum amount of compound being employed.

The compounds contained in the compound combination of the invention can be applied as such, directly to the seeds, i.e. without the use of any other components and without having been diluted. They can be applied in a simultaneous, separate or sequential manner. Also compositions containing the compounds contained in the compound combination of the invention, such as the composition of the invention, can be applied to the seeds.

The compound combination and the composition of the invention are suitable for protecting seeds of any plant variety. Preferred seeds are that of cereals (such as wheat, barley, rye, millet, triticale, and oats), oilseed rape, maize, cotton, soybean, rice, potatoes, sunflower, beans, coffee, peas, beet (e.g. sugar beet and fodder beet), peanut, vegetables (such as tomato, cucumber, onions and lettuce), lawns and ornamental plants. More preferred are seeds of wheat, soybean, oilseed rape, maize and rice.

The compound combination and the composition of the invention may be used for treating transgenic seeds, in particular seeds of plants capable of expressing a polypeptide or protein which acts against pests, herbicidal damage or abiotic stress, thereby increasing the protective effect. Seeds of plants capable of expressing a polypeptide or protein which acts against pests, herbicidal damage or abiotic stress may contain at least one heterologous gene which allows the expression of said polypeptide or protein. These heterologous genes in transgenic seeds may originate, for example, from microorganisms of the species Bacillus, Rhizobium, Pseudomonas, Serratia, Trichoderma, Clavibacter, Glomus or Gliocladium. These heterologous genes preferably originate from Bacillus sp., in which case the gene product is effective against the European corn borer and/or the Western corn rootworm. Particularly preferably, the heterologous genes originate from Bacillus thuringiensis.

Application

The compound combination of the invention can be applied as such, or for example in the form of as ready-to-use solutions, emulsions, water- or oil-based suspensions, powders, wettable powders, pastes, soluble powders, dusts, soluble granules, granules for broadcasting, suspoemulsion concentrates, natural products impregnated with the compound combination of the invention, synthetic substances impregnated with the compound combination of the invention, fertilizers or microencapsulations in polymeric substances.

Application is accomplished in a customary manner, for example by watering, spraying, atomizing, broadcasting, dusting, foaming or spreading-on. It is also possible to deploy the compound combination of the invention by the ultra-low volume method, via a drip irrigation system or drench application, to apply it in-furrow or to inject it into the soil stem or trunk. It is further possible to apply the compound combination of the invention by means of a wound seal, paint or other wound dressing. The effective and plant-compatible amount of the compound combination of the invention which is applied to the plants, plant parts, fruits, seeds or soil will depend on various factors, such as the compound/composition employed, the subject of the treatment (plant, plant part, fruit, seed or soil), the type of treatment (dusting, spraying, seed dressing), the purpose of the treatment (curative and protective), the type of microorganisms, the development stage of the microorganisms, the sensitivity of the microorganisms, the crop growth stage and the environmental conditions.

When the compound combination of the invention is used as a fungicide, the application rates can vary within a relatively wide range, depending on the kind of application. For the treatment of plant parts, such as leaves, the application rate may range from 0.1 to 10 000 g/ha, preferably from 10 to 1000 g/ha, more preferably from 50 to 300 g/ha (in the case of application by watering or dripping, it is even possible to reduce the application rate, especially when inert substrates such as rockwool or perlite are used). For the treatment of seeds, the application rate may range from 0.1 to 200 g per 100 kg of seeds, preferably from 1 to 150 g per 100 kg of seeds, more preferably from 2.5 to 25 g per 100 kg of seeds, even more preferably from 2.5 to 12.5 g per 100 kg of seeds. For the treatment of soil, the application rate may range from 0.1 to 10 000 g/ha, preferably from 1 to 5000 g/ha. The outlined application rates refer to the total application rates of compounds (A) and (B) present in the compound combination of the present invention.

These application rates are merely examples and are not intended to limit the scope of the present invention.

The compound combination of the invention can be used in combination with models e.g. embedded in computer programs for site specific crop management, satellite farming, precision farming or precision agriculture. Such models support the site specific management of agricultural sites with data from various sources such as soils, weather, crops (e.g. type, growth stage, plant health), weeds (e.g. type, growth stage), diseases, pests, nutrients, water, moisture, biomass, satellite data, yield etc. with the purpose to optimize profitability, sustainability and protection of the environment. In particular, such models can help to optimize agronomical decisions, control the precision of pesticide applications and record the work performed.

As an example, the compound of the invention can be applied to a crop plant according to appropriate dose regime if a model models the development of a fungal disease and calculates that a threshold has been reached for which it is recommendable to apply the compound of the invention to the crop plant.

Commercially available systems which include agronomic models are e.g. FieldScripts' from The Climate Corporation, Xarvio™ from BASF, AGLogic™ from John Deere, etc.

The compounds of the invention can also be used in combination with smart spraying equipment such as e.g. spot spraying or precision spraying equipment attached to or housed within a farm vehicle such as a tractor, robot, helicopter, airplane, unmanned aerial vehicle (UAV) such as a drone, etc. Such an equipment usually includes input sensors (such as e.g. a camera) and a processing unit configured to analyze the input data and configured to provide a decision based on the analysis of the input data to apply the compound of the invention to the crop plants (respectively the weeds) in a specific and precise manner. The use of such smart spraying equipment usually also requires positions systems (e.g. GPS receivers) to localize recorded data and to guide or to control farm vehicles; geographic information systems (GIS) to represent the information on intelligible maps, and appropriate farm vehicles to perform the required farm action such as the spraying.

In an example, fungal diseases can be detected from imagery acquired by a camera. In an example fungal diseases can be identified and/or classified based on that imagery. Such identification and/classification can make use of image processing algorithms. Such image processing algorithms can utilize machine learning algorithms, such as trained neutral networks, decision trees and utilize artificial intelligence algorithms. In this manner, the compounds described herein can be applied only where needed.

### EXAMPLES

Generality

Measurement of Log P Values

Measurement of Log P values as provided herein was performed according to EEC directive 79/831 Annex V.A8 by HPLC (High Performance Liquid Chromatography) on reversed phase columns with the following methods:
^{[a]} Log P value is determined by measurement of LC-UV, in an acidic range, with 0.1% formic acid in water and acetonitrile as eluent (linear gradient from 10% acetonitrile to 95% acetonitrile).
^{[b]} Log P value is determined by measurement of LC-UV, in a neutral range, with 0.001 molar ammonium acetate solution in water and acetonitrile as eluent (linear gradient from 10% acetonitrile to 95% acetonitrile).
^{[c]} Log P value is determined by measurement of LC-UV, in an acidic range, with 0.1% phosphoric acid and acetonitrile as eluent (linear gradient from 10% acetonitrile to 95% acetonitrile).

If more than one Log P value is available within the same method, all the values are given and separated by “+”. Calibration was done with straight-chain alkan2-ones (with 3 to 16 carbon atoms) with known Log P values (measurement of Log P values using retention times with linear interpolation between successive alkanones). Lambda-max-values were determined using UV-spectra from 200 nm to 400 nm and the peak values of the chromatographic signals

¹H-NMR Data

¹H-NMR data of selected examples as provided herein are written in form of ¹H-NMR-peak lists. To each signal peak are listed the δ-value in ppm and the signal intensity in round brackets. Between the δ-value—signal intensity pairs are semicolons as delimiters.

The peak list of an example has therefore the form:

δ₁ (intensity₁); δ₂ (intensity₂); . . . ; δᵢ (intensityᵢ); . . . ; δₙ(intensityₙ)

Intensity of sharp signals correlates with the height of the signals in a printed example of a NMR spectrum in cm and shows the real relations of signal intensities. From broad signals several peaks or the middle of the signal and their relative intensity in comparison to the most intensive signal in the spectrum can be shown.

For calibrating chemical shift for ¹H spectra, we use tetramethylsilane and/or the chemical shift of the solvent used, especially in the case of spectra measured in DMSO. Therefore in NMR peak lists, tetramethylsilane peak can occur but not necessarily.

The ¹H-NMR peak lists are similar to classical ¹H-NMR prints and contains therefore usually all peaks, which are listed at classical NMR-interpretation.

Additionally they can show like classical ¹H-NMR prints signals of solvents, stereoisomers of the target compounds, which are also object of the invention, and/or peaks of impurities.

To show compound signals in the delta-range of solvents and/or water the usual peaks of solvents, for example peaks of DMSO in DMSO-D₆ and the peak of water are shown in our ¹H-NMR peak lists and have usually on average a high intensity.

The peaks of stereoisomers of the target compounds and/or peaks of impurities have usually on average a lower intensity than the peaks of target compounds (for example with a purity >90%).

Such stereoisomers and/or impurities can be typical for the specific preparation process. Therefore their peaks can help to recognize the reproduction of our preparation process via “side-products-fingerprints”.

An expert, who calculates the peaks of the target compounds with known methods (MestreC, ACD-simulation, but also with empirically evaluated expectation values) can isolate the peaks of the target compounds as needed optionally using additional intensity filters. This isolation would be similar to relevant peak picking at classical 1H-NMR interpretation.

Further details of NMR-data description with peak lists you find in the publication “Citation of NMR Peaklist Data within Patent Applications” of the Research Disclosure Database Number 564025.

The following examples illustrate in a non-limiting manner the preparation and biological activity of the compounds of formula (I) according to the invention.

Synthesis of Compounds of Formula (I) and Intermediates

### Preparation Example 1: preparation of methyl N-[6-chloro-3-[3-(trifluoromethyl)phenoxy]pyridazine-4-carbonyl]-N-[2-(2,4-dimethylphenyl)-2,2-difluoro-ethyl]carbamate (compound I.335)

To a solution of 6-chloro-N-[2-(2,4-dimethylphenyl)-2,2-difluoro-ethyl]-3-[3-(trifluoromethyl)phenoxy]pyridazine-4-carboxamide (100 mg, 0.206 mmol) and potassium tert-butoxide (34 mg, 0.309 mmol) in THF (3 mL) was added methyl chloroformate (0.024 mL, 0.309 mmol). The reaction mixture was stirred 3 h at room temperature, then diluted with water and extracted with ethyl acetate (2×50 mL). The organic extracts were washed with brine, dried over magnesium sulfate, filtered and concentrated under reduced pressure. Purification of the residue by column chromatography on silica gel (gradient heptane/EtOAc) afforded, after evaporation of the solvents, 69 mg (88% purity, 54% yield of methyl N-[6-chloro-3-[3-(trifluoromethyl)phenoxy]pyridazine-4-carbonyl]-N-[2-(2,4-dimethylphenyl)-2,2-difluoro-ethyl]carbamate as an oil.

### Preparation Example 2: preparation of N-[2-(2,4-dimethylphenyl)ethyl]-6-methyl-3-[3-(trifluoro-methyl)phenoxy]pyridazine-4-carbothioamide (compound I.094)

In a microwave vial, N-[2-(2,4-dimethylphenyl)ethyl]-6-methyl-3-[3-(trifluoromethyl)phenoxy]pyridazine-4-carboxamide (97.7 mg, 0.22 mmol) and P₂S₅ (25.28 mg, 0.11 mmol) were dissolved in dioxane (4.8 mL). The tube was sealed and the reaction mixture was heated in the microwave at 130° C. for 10 min. The reaction mixture was diluted with water and extracted with ethyl acetate (2×50 mL). The organic extracts were washed with water and brine, dried over magnesium sulfate, filtered and concentrated under reduced pressure. Purification of the residue by column chromatography on silica gel (gradient heptane/EtOAc) afforded, after evaporation of the solvents, 27.5 mg (100% purity, 27% yield) of N-[2-(2,4-dimethylphenyl)ethyl]-6-methyl-3-[3-(trifluoromethyl)phenoxy]pyridazine-4-carbothioamide as a yellow solid.

### Preparation Example 3: preparation of 6-chloro-N-[2-(2,4-dimethylphenyl)-2,2-difluoro-ethyl]-3-[3-(trifluoromethyl)phenoxy]pyridazine-4-carboxamide (compound I.014)

### Step 1: preparation of ethyl 6-chloro-3-[3-(trifluoromethyl)phenoxy]pyridazine-4-carboxylate

Under argon, sodium hydride (2.8 g, 70 mmol) was added to a solution of 3-(trifluoromethyl)phenol (9.7 g, 60 mmol) in DMF (30 mL). The reaction mixture was stirred 1 h at room temperature, then ethyl 3,6-dichloropyridazine-4-carboxylate (13.8 g, 50 mmol) was added portionwise to the solution. The reaction mixture was stirred for 18 h at room temperature, then diluted with water and extracted with diethylether (3×200 mL). The organic extracts were washed with water and brine, dried over magnesium sulfate, filtered and concentrated under reduced pressure. Purification of the residue by column chromatography on silica gel (gradient heptane/EtOAc) afforded, after evaporation of the solvents, 20 g (90% purity, 100% yield) of ethyl 6-chloro-3-[3-(trifluoromethyl)phenoxy]pyridazine-4-carboxylate as an oil.

### Step 2: preparation of 6-chloro-3-[3-(trifluoromethyl)phenoxy]pyridazine-4-carboxylic acid

To a solution of ethyl 6-chloro-3-[3-(trifluoromethyl)phenoxy]pyridazine-4-carboxylate (15 g, 35 mmol) in dioxane/water 2:1 (75 mL) was added lithium hydroxide (2.5 g, 105 mmol). The reaction was stirred for 4 h at room temperature then diluted with water. The aqueous phase was acidified with 1M aqueous HCl solution and extracted with ethyl acetate (3×200 mL). The organic extracts were dried over magnesium sulfate, filtered and concentrated under reduced pressure. Evaporation of the solvents afforded 9.7 g (98% purity, 85% yield) of 6-chloro-3-[3-(trifluoromethyl)phenoxy]pyridazine-4-carboxylic acid as a solid.

### Step 3: preparation of 6-chloro-N-[2-(2,4-dimethylphenyl)-2,2-difluoro-ethyl]-3-[3-(trifluoromethyl)phenoxy]pyridazine-4-carboxamide

In a microwave vial, 6-chloro-3-[3-(trifluoromethyl)phenoxy]pyridazine-4-carboxylic acid (1.74 g, 9.4 mmol), triethylamine (2 mL, 14 mmol), propylphosphonic anhydride (5.19 g, 8.1 mmol, 50% in THF) and 2-(2,4-dimethylphenyl)-2,2-difluoro-ethanamine (1.74 g, 9.41 mmol) were dissolved in THF (10 mL). The tube was sealed and the reaction mixture was heated in the microwave at 130° C. for 15 min. The reaction mixture was diluted with water and extracted with ethyl acetate (2×50 mL). The organic extracts were washed with a saturated aqueous sodium bicarbonate solution and brine, dried over magnesium sulfate, filtered and concentrated under reduced pressure. Evaporation of the solvents afforded 3.2 g (93% purity, 98% yield) of 6-chloro-N-[2-(2,4-dimethylphenyl)-2,2-difluoro-ethyl]-3-[3-(trifluoromethyl)phenoxy]pyridazine-4-carboxamide as a white solid

### Preparation Example 4: preparation of N-[2-(4-bromo-2-chloro-phenyl)-2,2-difluoro-ethyl]-6-chloro-3-(2,3-difluorophenoxy)pyridazine-4-carboxamide (compound I.530)

### Step 1: preparation of N-[2-(4-bromo-2-chloro-phenyl)-2,2-difluoro-ethyl]-3,6-dichloro-pyridazine-4-carboxamide (compound 3.10)

To a white suspension of 3,6-dichloropyridazine-4-carboxylic acid (8.0 g, 41.4 mmol) in dichloromethane (50 mL) was added oxalyl chloride (7.89 g, 126.93 mmol) followed by two drops of DMF. The reaction mixture was stirred at room temperature for 1 h. To the pre-formed acyl chloride was added a solution of 2-(4-bromo-2-chloro-phenyl)-2,2-difluoro-ethanamine (11.77 g, 43.52 mmol) and triethylamine (11.55 mL, 82.90 mmol) in DCM (100 mL). The reaction mixture was stirred at room temperature for 1 h, then it was diluted with water and extracted with DCM (2×100 mL). The organic extracts were washed with water and brine, dried over magnesium sulfate, filtered and concentrated under reduced pressure. Purification of the residue by column chromatography on silica gel (gradient heptane/EtOAc) afforded, after evaporation of the solvents, 4.15 g (82% purity, 20% yield) of N-[2-(4-bromo-2-chloro-phenyl)-2,2-difluoro-ethyl]-3,6-dichloro-pyridazine-4-carboxamide as a white solid.

Step 2: preparation of N-[2-(4-bromo-2-chloro-phenyl)-2,2-difluoro-ethyl]-6-chloro-3-(2,3-difluoro-phenoxy)pyridazine-4-carboxamide

To a solution of N-[2-(4-bromo-2-chloro-phenyl)-2,2-difluoro-ethyl]-3,6-dichloro-pyridazine-4-carboxamide (150 mg, 0.33 mmol) in AcCN (4 mL) were added 2,3-difluorophenol (56.95 mg, 0.44 mmol) and potassium carbonate (93 mg, 0.67 mmol). The reaction mixture was stirred at room temperature for 18 h, then it was diluted with water and extracted with ethyl acetate (2×100 mL). The organic extracts were washed with water and brine, dried over magnesium sulfate, filtered and concentrated under reduced pressure. Purification of the residue by preparative HPLC afforded, after evaporation of the solvents, 85 mg (100% purity, 46% yield) of N-[2-(4-bromo-2-chloro-phenyl)-2,2-difluoro-ethyl]-6-chloro-3-(2,3-difluorophenoxy)pyridazine-4-carboxamide as a colourless oil.

### Preparation Example 5: preparation of 6-chloro-N-[2-(4-cyclopropyl-2-methyl-phenyl)-2,2-difluoro-ethyl]-3-[3-(tri-fluoromethyl)phenoxy]pyridazine-4-carboxamide (compound I.240)

Under argon, cyclopropylboronic acid (19.7 mg, 0.22 mmol) was added to a stirred solution of N-[2-(4-bromo-2-methyl-phenyl)-2,2-difluoro-ethyl]-6-chloro-3-[3-(trifluoromethyl)phenoxy]pyridazine-4-carboxamide (100 mg, 0.18 mmol), palladium acetate (8.5 mg, 0.018 mmol) and potassium phosphate (238.42 mg, 1.09 mmol) in toluene/water (20:1, 3 mL). The reaction mixture was stirred at 100° C. for 18 h, filtered over Celite®, washed with ethyl acetate and concentrated under reduced pressure. Purification of the residue by preparative HPLC afforded, after evaporation of the solvents, 22 mg (90% purity, 21% yield) of 6-chloro-N-[2-(4-cyclopropyl-2-methyl-phenyl)-2,2-difluoro-ethyl]-3-[3-(trifluoromethyl)phenoxy]pyridazine-4-carboxamide as colourless oil.

### Preparation Example 6: preparation of 3-(3-cyclobutylphenoxy)-N-[2-(2,4-dimethylphenyl)-2,2-difluoro-ethyl]-6-methyl-pyridazine-4-carboxamide (compound I.564)

Under argon, a solution of NiCl₂.glyme (0.23 mg, 0.001 mmol) and 4,4′-di-tert-butyl-2,2′-bipyridine (0.28 mg, 0.001 mmol) in dioxane (0.5 mL) was added to a mixture 3-(3-bromophenoxy)-N-[2-(2,4-dimethylphenyl)-2,2-difluoro-ethyl]-6-methyl-pyridazine-4-carboxamide (100 mg, 0.21 mmol), bromocyclobutane (57 mg, 0.42 mmol), tris(trimethylsilyl)silane (52 mg, 0.21 mmol), sodium carbonate (44 mg, 0.42 mmol) and [Ir(dF(CF₃)ppy)₂(dtbbpy)]PF₆ (2.3 mg, 0.002 mmol, CAS number 870987-63-6) dissolved in dioxane (1 mL). The reaction mixture was stirred at room temperature for 18 h under blue light irradiation (Kessyl lamp 40W), then filtered over Celite® and concentrated under reduced pressure. Purification of the residue by preparative HPLC afforded, after evaporation of the solvents, 14 mg (85% purity, 12% yield) of 3-(3-cyclobutylphenoxy)-N-[2-(2,4-dimethylphenyl)-2,2-difluoro-ethyl]-6-methyl-pyridazine-4-carboxamide as a colourless oil.

### Preparation Example 7: preparation of 6-acetyl-N-[rac-2-(4-bromo-2-chloro-phenyl)-2-fluoro-ethyl]-3-[3-(trifluoromethyl)phenoxy]pyridazine-4-carboxamide (compound I.605)

### Step 1: preparation of isopropyl 6-(1-ethoxyvinyl)-3-[3-(trifluoromethyl)phenoxy]pyridazine-4-carboxylate

In a microwave vial, isopropyl 6-chloro-3-[3-(trifluoromethyl)phenoxy]pyridazine-4-carboxylate (2.7 g, 7.5 mmol), tributyl(1-ethoxyvinyl)stannane (3.38 g, 9.35 mmol) and bis(triphenylphosphine)palladium dichloride (527 mg, 0.75 mmol) were dissolved under argon in DMF (10 mL). The tube was sealed and the reaction mixture was heated in the microwave at 120° C. for 20 min. The reaction mixture was diluted with water and extracted with ethyl acetate (2×50 mL). The organic extracts were washed with water and brine, dried over magnesium sulfate, filtered and concentrated under reduced pressure. Purification of the residue by column chromatography on silica gel (gradient heptane/EtOAc) afforded, after evaporation of the solvents, 2.2 g (95% purity, 70% yield) of isopropyl 6-(1-ethoxyvinyl)-3-[3-(trifluoromethyl)phenoxy]pyridazine-4-carboxylate as a solid.

### Step 2: preparation of isopropyl 6-acetyl-3-[3-(trifluoromethyl)phenoxy]pyridazine-4-carboxylate (compound I.075)

To a solution of isopropyl 6-(1-ethoxyvinyl)-3-[3-(trifluoromethyl)phenoxy]pyridazine-4-carboxylate (1.9 g, 4.9 mmol) in THF (20 mL) was added at room temperature a 2M aqueous HCl (7 mL, 14 mmol) solution. The reaction was stirred for 30 min then it was diluted with water and extracted with ethyl acetate (2×50 mL). The organic extracts were washed with water and brine, dried over magnesium sulfate, filtered and concentrated under reduced pressure. Purification of the residue by column chromatography on silica gel (gradient heptane/EtOAc) afforded, after evaporation of the solvents, 1.67 g (100% purity, 93% yield) of isopropyl 6-acetyl-3-[3-(trifluoromethyl)phenoxy]pyridazine-4-carboxylate as a oil.

### Step 3: preparation of 6-acetyl-3-[3-(trifluoromethyl)phenoxy]pyridazine-4-carboxylic acid (compound I.034)

To a solution of isopropyl 6-acetyl-3-[3-(trifluoromethyl)phenoxy]pyridazine-4-carboxylate (600 mg, 1.63 mmol) in THF/water 9:1 (5.5 mL) cooled at 0° C. was added lithium hydroxide (80 mg, 3.2 mmol). The reaction was stirred for 1 h at room temperature then it was diluted with water. The aqueous phase was acidified with 1M aqueous HCl solution and extracted with ethyl acetate (2×50 mL). The organic extracts were dried over magnesium sulfate, filtered and concentrated under reduced pressure. Evaporation of the solvents afforded 540 mg (90% purity, 91% yield) of 6-acetyl-3-[3-(trifluoromethyl)phenoxy]pyridazine-4-carboxylic acid as a solid.

### Step 4: preparation of 6-acetyl-N-[rac-2-(4-bromo-2-chloro-phenyl)-2-fluoro-ethyl]-3-[3-(trifluoromethyl)phenoxy]pyridazine-4-carboxamide

In a microwave vial, 6-acetyl-3-[3-(trifluoromethyl)phenoxy]pyridazine-4-carboxylic acid (350 mg, 1.1 mmol), triethylamine (0.6 mL, 4 mmol), propylphosphonic anhydride (2.05 g, 3.22 mmol, 50% in THF) and rac-2-(4-bromo-2-chloro-phenyl)-2-fluoro-ethanamine.hydrochloride (465 mg, 1.61 mmol) were dissolved in THF (7 mL). The tube was sealed and the reaction mixture was heated in the microwave at 130° C. for 15 min. The reaction mixture was diluted with water and extracted with ethyl acetate (2×50 mL). The organic extracts were washed with a saturated aqueous sodium bicarbonate solution and brine, dried over magnesium sulfate, filtered and concentrated under reduced pressure. Purification of the residue by column chromatography on silica gel (gradient heptane/EtOAc) afforded, after evaporation of the solvents, 336 mg (92% purity, 51% yield) of 6-acetyl-N-[rac-2-(4-bromo-2-chloro-phenyl)-2-fluoro-ethyl]-3-[3-(trifluoromethyl)phenoxy]pyridazine-4-carboxamide as a solid.

### Preparation Example 8: preparation of N-[2-(2,4-dimethylphenyl)-2,2-difluoro-ethyl]-6-iodo-3-[3-(trifluoromethyl)phenoxy]pyridazine-4-carboxamide (compound I.461)

### Step 1: preparation of isopropyl 6-iodo-3-[3-(trifluoromethyl)phenoxy]pyridazine-4-carboxylate (compound I.066)

Under argon, sodium iodide (10.4 g, 69.3 mmol) was added at room temperature to a solution of isopropyl 6-chloro-3-[3-(trifluoromethyl)phenoxy]pyridazine-4-carboxylate (10.0 g, 27.7 mmol) in hydriodic acid (30 mL, 57% in water). AcCN (20 mL) was added and the mixture was stirred at 40° C. for 4 h. The reaction was stopped by addition of 1M aqueous NaOH solution, the pH was adjusted to 3-4 and the reaction mixture was extracted with ethyl acetate (3×200 mL). The organic extracts were washed with water and brine, dried over magnesium sulfate, filtered and concentrated under reduced pressure. Purification of the residue by column chromatography on silica gel (gradient heptane/EtOAc) afforded, after evaporation of the solvents, 4.3 g (86% purity, 30% yield) of isopropyl 6-iodo-3-[3-(trifluoromethyl)phenoxy]pyridazine-4-carboxylate as a solid.

### Step 2: preparation of 6-iodo-3-[3-(trifluoromethyl)phenoxy]pyridazine-4-carboxylic acid

To a solution of isopropyl 6-iodo-3-[3-(trifluoromethyl)phenoxy]pyridazine-4-carboxylate (800 mg, 1.77 mmol) in THF/water 9:1 (44 mL) cooled at 0° C. was added lithium hydroxide (51 mg, 2.12 mmol). The reaction was stirred for 30 min at 0° C. then it was diluted with water. The aqueous phase was acidified with 1M aqueous HCl solution and extracted with ethyl acetate (2×100 mL). The organic extracts were dried over magnesium sulfate, filtered and concentrated under reduced pressure. Evaporation of the solvents afforded 657 mg (100% purity, 90% yield) of 6-iodo-3-[3-(trifluoromethyl)phenoxy]pyridazine-4-carboxylic acid was obtained as a solid.

### Step 3: preparation of N-[2-(2,4-dimethylphenyl)-2,2-difluoro-ethyl]-6-iodo-3-[3-(trifluoro-methyl)phenoxy]pyridazine-4-carboxamide

In a microwave vial, 6-iodo-3-[3-(trifluoromethyl)phenoxy]pyridazine-4-carboxylic acid (657 mg, 1.6 mmol), triethylamine (0.9 mL, 6.4 mmol), propylphosphonic anhydride (3.05 g, 4.81 mmol, 50% in THF) and 2-(2,4-dimethylphenyl)-2,2-difluoro-ethanamine were dissolved in THF (8 mL). The tube was sealed and the reaction mixture was heated in the microwave at 130° C. for 15 min. The reaction mixture was diluted with water and extracted with ethyl acetate (2×100 mL). The organic extracts were washed with brine, dried over magnesium sulfate, filtered and concentrated under reduced pressure. Purification of the residue by column chromatography on silica gel (gradient heptane/EtOAc) afforded, after evaporation of the solvents, 621 mg (97% purity, 60% yield) of N-[2-(2,4-dimethylphenyl)-2,2-difluoro-ethyl]-6-iodo-3-[3-(trifluoromethyl)phenoxy]pyridazine-4-carboxamide as a solid.

### Preparation Example 9: preparation of N-[2-(4-bromo-2-chloro-phenyl)-2,2-difluoro-ethyl]-6-chloro-5-(2-methoxyethyl)-3-[3-(trifluoromethyl)phenoxy]pyridazine-4-carboxamide (compound I.070)

### Step 1: preparation of methyl 6-chloro-5-iodo-3-[3-(trifluoromethyl)phenoxy]pyridazine-4-carboxylate (compound I.052)

Under argon, a solution of TMPZnCl.LiCl (1.22 mL, 0.66 mL, 17% in THF, CAS number 109-99-9) was added to methyl 6-chloro-3-[3-(trifluoromethyl)phenoxy]pyridazine-4-carboxylate (200 mg, 0.6 mmol) in THF (1.2 mL). After stirring 1 h at room temperature, NIS (203 mg, 0.90 mmol) was added. The reaction mixture was stirred 3 h at room temperature, then it was diluted with a saturated sodium thiosulfate solution and extracted with ethyl acetate (2×50 mL). The organic extracts were washed with brine, dried over magnesium sulfate, filtered and concentrated under reduced pressure. Purification of the residue by column chromatography on silica gel (gradient heptane/EtOAc) afforded, after evaporation of the solvents, 191 mg (97% purity, 67% yield) of methyl 6-chloro-5-iodo-3-[3-(trifluoromethyl)phenoxy]pyridazine-4-carboxylate as a yellow solid.

### Step 2: preparation of methyl 6-chloro-3-[3-(trifluoromethyl)phenoxy]-5-vinyl-pyridazine-4-carboxylate (compound I.069)

Under argon, in a microwave vial 6-chloro-5-iodo-3-[3-(trifluoromethyl)phenoxy]pyridazine-4-carboxylate (500 mg, 1.1 mmol), potassium vinyltrifluoroborate (146 mg, 1.1 mmol), potassium phosphate (463 mg, 2.18 mmol) and [1,1′-Bis(diphenylphosphino)ferrocene]dichloropalladium(II) (179 mg, 0.22 mmol) were dissolved in DME/water 2:1 (10 mL). The tube was sealed and the reaction mixture was heated in the microwave at 110° C. for 30 min. The reaction mixture was diluted with a saturated ammonium chloride solution and extracted with ethyl acetate (2×50 mL). The organic extracts were washed with brine, dried over magnesium sulfate, filtered and concentrated under reduced pressure. Purification of the residue by column chromatography on silica gel (gradient heptane/EtOAc) afforded, after evaporation of the solvents, 255 mg (98% purity, 64% yield) of methyl 6-chloro-3-[3-(trifluoromethyl)phenoxy]-5-vinyl-pyridazine-4-carboxylate as a solid.

### Step 3: preparation of methyl 6-chloro-5-(2-methoxyethyl)-3-[3-(trifluoromethyl)phenoxy]pyridazine-4-carboxylate

Sodium methoxide (93 mg, 1.71 mmol) was added to a solution of methyl 6-chloro-3-[3-(trifluoromethyl)phenoxy]-5-vinyl-pyridazine-4-carboxylate (880 mg, 2.46 mmol) in methanol (15 mL). The reaction mixture was stirred for 1 h at room temperature. The reaction mixture was diluted with a saturated aqueous sodium bicarbonate solution and extracted with ethyl acetate (2×100 mL). The organic extracts were washed with brine, dried over magnesium sulfate, filtered and concentrated under reduced pressure. Purification of the residue by column chromatography on silica gel (gradient heptane/EtOAc) afforded, after evaporation of the solvents, 223 mg (93% purity, 22% yield) of methyl 6-chloro-5-(2-methoxyethyl)-3-[3-(trifluoromethyl)phenoxy]pyridazine-4-carboxylate as an oil.

### Step 4: preparation of 6-chloro-5-(2-methoxyethyl)-3-[3-(trifluoromethyl)phenoxy]pyridazine-4-carboxylic acid (compound I.026)

To a solution of methyl 6-chloro-5-(2-methoxyethyl)-3-[3-(trifluoromethyl)phenoxy]pyridazine-4-carboxylate (272 mg, 0.67 mmol) in THF/water 9:1 (4 mL) was added lithium hydroxide (33 mg, 1.4 mmol). The reaction was stirred for 8 h at room temperature then it was diluted with water. The aqueous phase was acidified with 1M aqueous HCl solution and extracted with ethyl acetate (2×50 mL). The organic extracts were dried over magnesium sulfate, filtered and concentrated under reduced pressure. Evaporation of the solvents afforded 210 mg (100% purity, 80% yield) of 6-chloro-5-(2-methoxyethyl)-3-[3-(trifluoromethyl)phenoxy]pyridazine-4-carboxylic acid as a solid.

### Step 5: preparation of N-[2-(4-bromo-2-chloro-phenyl)-2,2-difluoro-ethyl]-6-chloro-5-(2-methoxyethyl)-3-[3-(trifluoromethyl)phenoxy]pyridazine-4-carboxamide

Under argon, to a solution of 6-chloro-5-(2-methoxyethyl)-3-[3-(trifluoromethyl)phenoxy]pyridazine-4-carboxylic acid (50 mg, 0.133 mmol) and HATU (100 mg, 0.26 mmol) in DMF (2 mL) were successively added 2-(4-bromo-2-chloro-phenyl)-2,2-difluoro-ethanamine hydrochloride (53 mg, 0.17 mmol) and N,N-diisopropylethylamine (0.12 mL, 0.66 mmol). The reaction mixture was stirred for 3 h at room temperature then it was diluted with water and extracted with ethyl acetate (2×50 mL). The organic extracts were dried over magnesium sulfate, filtered and concentrated under reduced pressure. Purification of the residue by preparative HPLC afforded, after evaporation of the solvents, 34 mg (100% purity, 40% yield) of N-[2-(4-bromo-2-chloro-phenyl)-2,2-difluoro-ethyl]-6-chloro-5-(2-methoxyethyl)-3-[3-(trifluoromethyl)phenoxy]pyridazine-4-carboxamide as a colourless oil.

### Preparation Example 10: preparation of 6-chloro-N-[2-(2,4-dimethylphenyl)-2,2-difluoro-ethyl]-5-iodo-3-[3-(trifluoromethyl)phenoxy]pyridazine-4-carboxamide (compound I.020)

Under argon, a solution of TMPZnCl.LiCl (12.35 mmol, 22.7 mL, 17% in THF, CAS number 109-99-9) was added to 6-chloro-N-[2-(2,4-dimethylphenyl)-2,2-difluoro-ethyl]-3-[3-(trifluoromethyl)phenoxy]pyridazine-4-carboxamide (3.0 g, 6.2 mmol) in THF (30 mL). After stirring 1 h at room temperature, NIS (3.4 g, 15.4 mmol) was added portionwise. The reaction mixture was stirred 2 h at room temperature, then it was diluted with a saturated sodium thiosulfate solution and saturated sodium bicarbonate solution, and extracted with ethyl acetate (2×250 mL). The organic extracts were washed with brine, dried over magnesium sulfate, filtered and concentrated under reduced pressure. Purification of the residue by column chromatography on silica gel (gradient heptane/EtOAc) afforded, after evaporation of the solvents, 3.05 g (100% purity, 80% yield) of 6-chloro-N-[2-(2,4-dimethylphenyl)-2,2-difluoro-ethyl]-5-iodo-3-[3-(trifluoromethyl)phenoxy]pyridazine-4-carboxamide as a solid.

### Preparation Example 11: preparation of 6-chloro-N-[2-(2,4-dimethylphenyl)-2,2-difluoro-ethyl]-5-(oxetan-3-ylamino)-3-[3-(trifluoromethyl)phenoxy]pyridazine-4-carboxamide (compound I.408)

Under argon, oxetan-3-amine (14.3 mg, 0.20 mmol) and N,N-diisopropylethylamine (0.034 mL, 0.20 mmol) were added at room temperature to a solution of 6-chloro-N-[2-(2,4-dimethylphenyl)-2,2-difluoro-ethyl]-5-iodo-3-[3-(trifluoromethyl)phenoxy]pyridazine-4-carboxamide (100 mg, 0.16 mmol) in AcCN (3 mL). The reaction mixture was stirred at 60° C. for 18 h, then it was diluted with water and extracted with ethyl acetate (2×50 mL). The organic extracts were washed with brine, dried over magnesium sulfate, filtered and concentrated under reduced pressure. Purification of the residue by column chromatography on silica gel (gradient heptane/EtOAc) afforded, after evaporation of the solvents, 79 mg (90% purity, 78% yield) of 6-chloro-N-[2-(2,4-dimethylphenyl)-2,2-difluoro-ethyl]-5-(oxetan-3-ylamino)-3-[3-(trifluoromethyl)phenoxy]pyridazine-4-carboxamide as a solid.

### Preparation Example 12: preparation of 6-chloro-N-[2-(4-chlorophenyl)-2,2-difluoro-ethyl]-5-ethyl-3-[3-(trifluoromethyl)phenoxy]pyridazine-4-carboxamide (compound I.254)

Under argon, a solution of EtMgBr (2.26 mL, 2.03 mmol, 0.9 M in THF) was added at −20° C. to a solution of 6-chloro-N-[2-(4-chlorophenyl)-2,2-difluoro-ethyl]-3-[3-(trifluoromethyl)phenoxy]pyridazine-4-carboxamide (200.0 mg, 0.40 mmol) in THF (5 mL). The reaction mixture was stirred 30 min at −20° C., then MeOH (1 mL) and NBS (86.7 mg, 0.49 mmol) were added. The reaction mixture was further stirred at room temperature for 2 h, then it was diluted with a saturated ammonium chloride solution and extracted with ethyl acetate (2×50 mL). The organic extracts were washed with water, dried over magnesium sulfate, filtered and concentrated under reduced pressure. Purification of the residue by column chromatography on silica gel (gradient heptane/EtOAc) afforded, after evaporation of the solvents, 94 mg (100% purity, 45% yield) of 6-chloro-N-[2-(4-chlorophenyl)-2,2-difluoro-ethyl]-5-ethyl-3-[3-(trifluoromethyl)phenoxy]pyridazine-4-carboxamide as a solid.

### Preparation Example 13: preparation 6-chloro-N-[2-(2,4-dimethylphenyl)-2,2-difluoro-ethyl]-5-(3-pyridyl)-3-[3-(trifluoromethyl)phenoxy]pyridazine-4-carboxamide (compound I.550)

Under argon, a solution of TMPZnCl.LiCl (0.86 mmol, 1.6 mL, 17% in THF) was added to 6-chloro-N-[2-(2,4-dimethylphenyl)-2,2-difluoro-ethyl]-3-[3-(trifluoromethyl)phenoxy]pyridazine-4-carboxamide (200 mg, 0.41 mmol) in THF (2 mL). After stirring 1 h at room temperature, 3-bromopyridine (0.048 mL, 0.49 mmol), palladium acetate (71 mg, 0.123 mmol), and trifurylphosphine (57.3 mg, 0.24 mmol) were added. The reaction mixture was stirred at 60° C. for 4 h, then diluted with a saturated ammonium chloride solution and a saturated sodium thiosulfate solution, and extracted with ethyl acetate (2×50 mL). The organic extracts were washed with brine, dried over magnesium sulfate, filtered and concentrated under reduced pressure. Purification of the residue by column chromatography on silica gel (gradient heptane/EtOAc) afforded, after evaporation of the solvents, 227 mg (96% purity, 94% yield) of 6-chloro-N-[2-(2,4-dimethylphenyl)-2,2-difluoro-ethyl]-5-(3-pyridyl)-3-[3-(trifluoro-methyl)phenoxy]pyridazine-4-carboxamide as a solid.

### Preparation Example 14: preparation of N-[2-(2,4-dimethylphenyl)-2,2-difluoro-ethyl]-6-methylsulfanyl-3-[3-(trifluoromethyl)phenoxy]pyridazine-4-carboxamide (compound I.767)

### Step 1: preparation of ethyl 6-methylsulfanyl-3-[3-(trifluoromethyl)phenoxy]pyridazine-4-carboxylate

Under argon, sodium methanethiolate (85 mg, 1.15 mmol) was added to a solution of ethyl 6-chloro-3-[3-(trifluoromethyl)phenoxy]pyridazine-4-carboxylate (400 mg, 1.15 mmol) in DMF (3 mL). The reaction mixture was stirred 2 h at room temperature, then diluted with saturated ammonium chloride solution and extracted with ethyl acetate (2×100 mL). The organic extracts were washed with water and brine, dried over magnesium sulfate, filtered and concentrated under reduced pressure. Purification of the residue by preparative HPLC afforded, after evaporation of the solvents, 43 mg (100% purity, 10% yield) of ethyl 6-methylsulfanyl-3-[3-(trifluoromethyl)phenoxy]pyridazine-4-carboxylate as an oil.

### Step 2: preparation of 6-methylsulfanyl-3-[3-(trifluoromethyl)phenoxy]pyridazine-4-carboxylic acid (compound I.004)

To a solution of ethyl 6-methylsulfanyl-3-[3-(trifluoromethyl)phenoxy]pyridazine-4-carboxylate (71 mg, 0.20 mmol) in THF/water 2:1 (1.5 mL) was added lithium hydroxide (6 mg, 0.24 mmol). The reaction was stirred for 1 h at room temperature then it was diluted with water. The aqueous phase was acidified with 1M aqueous HCl solution and extracted with ethyl acetate (2×50 mL). The organic extracts were dried over magnesium sulfate, filtered and concentrated under reduced pressure. Evaporation of the solvents afforded 34 mg (100% purity, 51% yield) of 6-methylsulfanyl-3-[3-(trifluoromethyl)phenoxy]pyridazine-4-carboxylic acid as a white solid.

### Step 3: preparation of N-[2-(2,4-dimethylphenyl)-2,2-difluoro-ethyl]-6-methylsulfanyl-3-[3-(trifluoromethyl)phenoxy]pyridazine-4-carboxamide

In a microwave vial, 6-methylsulfanyl-3-[3-(trifluoromethyl)phenoxy]pyridazine-4-carboxylic acid (34 mg, 0.10 mmol), triethylamine (0.06 mL, 0.4 mmol), propylphosphonic anhydride (195 mg, 0.30 mmol, 50% in THF) and 2-(2,4-dimethylphenyl)-2,2-difluoro-ethanamine hydrochloride (34 mg; 0.15 mmol) were dissolved in THF (0.4 mL). The tube was sealed and the reaction mixture was stirred at room temperature for 1 h. The reaction mixture was diluted with water and extracted with ethyl acetate (2×50 mL). The organic extracts was dried over magnesium sulfate, filtered and concentrated under reduced pressure. After evaporation of the solvents, 21 mg (100% purity, 41% yield) of N-[2-(2,4-dimethylphenyl)-2,2-difluoro-ethyl]-6-methylsulfanyl-3-[3-(trifluoromethyl)phenoxy]pyridazine-4-carboxamide as a yellow solid.

### Preparation Example 15: preparation of 6-chloro-3-(3-chlorophenoxy)-N-[2-(2,4-dimethylphenyl)-2,2-difluoro-ethyl]-5-methyl-pyridazine-4-carboxamide (compound I.790)

### Step 1: preparation of methyl 6-chloro-3-(3-chlorophenoxy)-5-methyl-pyridazine-4-carboxylate (compound I.033)

To a solution of methyl 6-chloro-3-(3-chlorophenoxy)pyridazine-4-carboxylate (24 g, 80 mmol) in dimethyl sulfoxide (75 mL) was added at room temperature nitromethane (24 g, 400 mmol). After 30 min, triethylamine (16.7 mL, 120 mmol) was added. The reaction mixture was stirred at room temperature for 3 days then it was diluted with water. The aqueous phase was extracted with ethyl acetate (500 mL) and the organic extract was dried over magnesium sulfate, filtered and concentrated under reduced pressure. Purification of the residue by column chromatography on silica gel (gradient heptane/EtOAc) afforded, after evaporation of the solvents, 18.9 g (96% purity, 72% yield) of methyl 6-chloro-3-(3-chlorophenoxy)-5-methyl-pyridazine-4-carboxylate as a yellow oil.

### Step 2: preparation of 6-chloro-3-(3-chlorophenoxy)-5-methyl-pyridazine-4-carboxylic acid (compound I.002)

To a solution of methyl 6-chloro-3-(3-chlorophenoxy)-5-methyl-pyridazine-4-carboxylate (8 g, 25 mmol) in THF/water 2:1 (60 mL) was added at 0° C. lithium hydroxide (2.3 g, 31 mmol). The reaction was stirred for 4 h at room temperature then it was diluted with water. The aqueous phase was extracted with diethyl ether (2×60 mL) then acidified with 1M aqueous HCl solution. The aqueous phase was cooled to 0° C., the white precipitate was filtered off, dried under reduced pressure to afford 7.2 g (97% purity, 91% yield) of 6-chloro-3-(3-chlorophenoxy)-5-methyl-pyridazine-4-carboxylic acid as a white solid.

### Step 3: preparation of 6-chloro-3-(3-chlorophenoxy)-N-[2-(2,4-dimethylphenyl)-2,2-difluoro-ethyl]-5-methyl-pyridazine-4-carboxamide

Under argon, to a solution of 6-chloro-3-(3-chlorophenoxy)-5-methyl-pyridazine-4-carboxylic acid (200 mg, 0.67 mmol) and HATU (0.33 g, 0.87 mmol) cooled at 0° C. in DMF (3 mL) were successively added 2-(2,4-dimethylphenyl)-2,2-difluoro-ethanamine hydrochloride (185 mg, 0.84 mmol) and N,N-diisopropylethylamine (0.35 mL, 2.0 mmol). The reaction mixture was stirred for 18 h at room temperature then it was diluted with water and extracted with ethyl acetate (2×200 mL). The organic extracts were dried over magnesium sulfate, filtered and concentrated under reduced pressure. Purification of the residue by column chromatography on silica gel (gradient heptane/EtOAc) afforded, after evaporation of the solvents, 200 mg (97% purity, 62% yield) of 6-chloro-3-(3-chlorophenoxy)-N-[2-(2,4-dimethylphenyl)-2,2-difluoro-ethyl]-5-methyl-pyridazine-4-carboxamide as a white solid.

The compounds as shown in table 1 below were prepared in analogy with the examples provided above. ¹H-NMR data of these compounds is shown in table 2.

TABLE 1
Compounds according to formula (I)
(I)

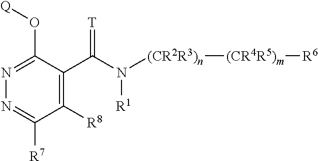

| Ex No | R¹ | R⁷ | R⁸ | T | Q | 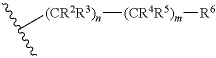 | LogP |
|---|---|---|---|---|---|---|---|
| I-001 | H | Cl | H | O | 3-(trifluoromethyl)phenyl | 2-(2,4-dichlorophenyl)ethyl | 4.46^{[a]} |
| I-002 | H | H | H | O | 3-(trifluoromethyl)phenyl | 2-(2,4-dimethylphenyl)-2,2-difluoroethyl | 3.90^{[a]} |
| I-003 | H | Cl | methyl | O | 3-(trifluoromethyl)phenyl | 2-(2-methyl-1,3-benzoxazol-4-yl)ethyl | 3.39^{[a]} |
| I-004 | H | 3-fluoropyridin- | H | O | 3-(trifluoromethyl)phenyl | 2-(2,4-dimethylphenyl)-2,2-difluoroethyl | 4.41^{[a]}; |
| | | 4-yl | | | | | 4.41^{[b]} |
| I-005 | H | Cl | methyl | O | 3-(trifluoromethyl)phenyl | rac-1-(3,4-dimethylphenyl)ethyl | 4.15^{[a]} |
| I-006 | H | Cl | H | O | naphthalen-2-yl | 2-(2,4-dichlorophenyl)-2,2-difluoroethyl | 4.78^{[a]} |
| I-007 | H | Cl | H | O | 3-(trifluoromethyl)phenyl | 2-(2-chloro-4-methoxyphenyl)-2,2- | 4.00^{[a]} |
| | | | | | | difluoroethyl | |
| I-008 | H | Cl | H | O | 3-(trifluoromethyl)phenyl | isoquinolin-7-ylmethyl | 1.87^{[a]} |
| I-009 | H | methyl | 1H-pyrazol-1-yl | O | 3-(trifluoromethyl)phenyl | 2-(2,4-dimethylphenyl)-2,2-difluoroethyl | 3.91^{[a]}; |
| | | | | | | | 3.81^{[b]} |
| I-010 | H | Cl | I | O | 3-(difluoromethyl)phenyl | 2-(4-chlorophenyl)-2,2-difluoroethyl | 3.94^{[a]} |
| I-011 | H | 3-methoxypyridin- | H | O | 3-(trifluoromethyl)phenyl | 2-(2,4-dimethylphenyl)-2,2-difluoroethyl | 3.94^{[a]}; |
| | | 4-yl | | | | | 4.21^{[b]} |
| I-012 | H | methyl | 2-methoxyethyl | O | 3-(trifluoromethyl)phenyl | 2-(2,4-dimethylphenyl)-2,2-difluoroethyl | 4.11^{[a]} |
| I-013 | H | methyl | H | O | 3-(trifluoromethyl)phenyl | 2-(4-chlorophenyl)propan-2-yl | 4.01^{[a]} |
| I-014 | H | Cl | H | O | 3-(trifluoromethyl)phenyl | 2-(2,4-dimethylphenyl)-2,2-difluoroethyl | 4.46^{[a]} |
| I-015 | H | Cl | cyclopropylamino | O | 3-(trifluoromethyl)phenyl | 2-(2,4-dichlorophenyl)-2,2-difluoroethyl | 4.25^{[a]} |
| (*) I-016 | H | cyclopropyl | H | O | 3-(trifluoromethyl)phenyl | 2-(2,4-dichlorophenyl)-2-fluoroethyl | 4.69^{[a]} |
| I-017 | H | methyl | H | O | 3-(trifluoromethyl)phenyl | 2-(4-methoxyphenyl)propan-2-yl | 3.51^{[a]} |
| I-018 | H | methyl | H | O | 3-(trifluoromethyl)phenyl | 2-(2-chloro-4-cyclohexylphenyl)-2,2- | 5.44^{[a]} |
| | | | | | | difluoroethyl | |
| I-019 | H | Cl | H | O | 3-(trifluoromethyl)phenyl | 2-(3,5-dimethylphenyl)-2,2-difluoroethyl | 4.46^{[a]} |
| I-020 | H | Cl | I | O | 3-(trifluoromethyl)phenyl | 2-(2,4-dimethylphenyl)-2,2-difluoroethyl | 4.61^{[a]} |
| I-021 | H | CF3 | H | O | 3-(trifluoromethyl)phenyl | 2-(4-bromo-2-chlorophenyl)-2,2- | 4.90^{[a]} |
| | | | | | | difluoroethyl | |
| I-022 | H | 3-methylpyridin- | H | O | 3-(trifluoromethyl)phenyl | 2-(2,4-dimethylphenyl)-2,2-difluoroethyl | 3.49^{[a]}; |
| | | 4-yl | | | | | 4.27^{[b]} |
| I-023 | H | Cl | H | O | 3-(trifluoromethyl)phenyl | rac-1-naphthalen-2-ylethyl | 4.28^{[a]} |
| (*) I-024 | H | cyclopropyl | H | O | 3-(trifluoromethyl)phenyl | 2-(2,4-dichlorophenyl)-2-fluoroethyl | 4.69^{[a]} |
| I-025 | H | H | cyclopropylamino | O | 3-(trifluoromethyl)phenyl | 2-(4-chlorophenyl)-2,2-difluoroethyl | 4.39^{[a]}; |
| | | | | | | | 4.20^{[b]} |
| I-026 | H | methyl | H | O | 3-(trifluoromethyl)phenyl | 2-(4-fluorophenyl)propan-2-yl | 3.62^{[a]} |
| I-027 | H | methyl | methyl | O | 3-(trifluoromethyl)phenyl | 2-(2,4-dichlorophenyl)ethyl | 3.73^{[a]} |
| I-028 | H | methyl | H | O | 3-(trifluoromethyl)phenyl | 2-(2-chloro-4-cyclobutylphenyl)-2,2- | 4.83^{[a]} |
| | | | | | | difluoroethyl | |
| I-029 | H | Cl | methyl | O | 3-cyclopropylphenyl | 2-(2,4-dichlorophenyl)ethyl | 4.51^{[a]} |
| I-030 | H | Cl | H | O | 3-(trifluoromethyl)phenyl | 2-(4-chlorophenyl)-2,2-difluoroethyl | 4.27^{[a]} |
| I-031 | H | methyl | H | O | 3-(trifluoromethyl)phenyl | [5-chloro-7-(trifluoromethyl)imidazo[1,2- | 3.17^{[a]} |
| | | | | | | a]pyridin-2-yl]methyl | |
| I-032 | H | Cl | H | O | 5-(trifluoromethyl)pyridin- | rac-2-(2,4-dichlorophenyl)-2-fluoroethyl | 3.73^{[a]}; |
| | | | | | 3-yl | | 3.89^{[b]} |
| I-033 | H | Cl | I | O | 3-(trifluoromethyl)phenyl | rac-2-(2,4-dichlorophenyl)-2-fluoroethyl | 4.46^{[a]} |
| I-034 | H | methyl | H | O | 3-(trifluoromethyl)phenyl | 2-[3-(trifluoromethyl)phenyl]propan-2-yl | 3.96^{[a]} |
| I-035 | H | methyl | H | O | 3-(trifluoromethyl)phenyl | 2-(2-chloro-4-cyclopentylphenyl)-2,2- | 5.08^{[a]} |
| | | | | | | difluoroethyl | |
| I-036 | H | Cl | H | O | 3-(trifluoromethyl)phenyl | 2-(4-methoxyphenyl)ethyl | 3.61^{[a]} |
| I-037 | H | Cl | H | O | 3-(trifluoromethyl)phenyl | 2-[3-(trifluoromethyl)pyridin-2-yl]ethyl | 3.65^{[a]} |
| I-038 | H | CF3 | H | O | 3-(trifluoromethyl)phenyl | 2-(4-chlorophenyl)-2,2-difluoroethyl | 4.49^{[a]} |
| I-039 | H | methyl | CF3 | O | 3-(trifluoromethyl)phenyl | 2-(4-chlorophenyl)-2,2-difluoroethyl | 4.29^{[a]} |
| I-040 | H | Cl | 2-methoxyethyl | O | 3-(trifluoromethyl)phenyl | 2-(2,4-dichlorophenyl)-2,2-difluoroethyl | 4.80^{[a]} |
| I-041 | H | methyl | ethyl | O | 3-(trifluoromethyl)phenyl | 2-(4-chlorophenyl)-2,2-difluoroethyl | 3.87^{[a]} |
| I-042 | H | Cl | H | O | 5-(trifluoromethyl)pyridin- | 2-(2,4-dichlorophenyl)-2,2-difluoroethyl | 4.06^{[a]}; |
| | | | | | 3-yl | | 4.08^{[b]} |
| I-043 | H | H | cyclopropylamino | O | 3-(trifluoromethyl)phenyl | 2-(2,4-dimethylphenyl)-2,2-difluoroethyl | 4.73^{[a]}; |
| | | | | | | | 4.88^{[b]} |
| I-044 | H | methyl | H | O | 3-(trifluoromethyl)phenyl | 2-(4-methylphenyl)propan-2-yl | 3.96^{[a]} |
| I-045 | H | methyl | ethyl | O | 3-(trifluoromethyl)phenyl | rac-2-(2,4-dichlorophenyl)-2-fluoroethyl | 4.15^{[a]} |
| I-046 | H | methyl | H | O | 3-(trifluoromethyl)phenyl | 2-[2-chloro-4-[rac-oxolan-3-yl]phenyl]- | 3.48^{[a]} |
| | | | | | | 2,2-difluoroethyl | |
| I-047 | H | Cl | methyl | O | 3-cyclopropyl-2- | rac-2-(4-bromo-2-chlorophenyl)-2- | 4.61^{[a]} |
| | | | | | fluorophenyl | fluoroethyl | |
| I-048 | H | methyl | H | O | 3-(trifluoromethyl)phenyl | rac-6-bromo-1,2,3,4-tetrahydro- | 4.32^{[a]}; |
| | | | | | | naphthalen-1-yl | 4.25^{[b]} |
| I-049 | H | methyl | H | O | 3-(trifluoromethyl)phenyl | (2,4-dimethylphenyl)methoxy | 3.55^{[a]} |
| I-050 | H | methyl | methyl | O | 3-(trifluoromethyl)phenyl | rac-2-(4-chlorophenyl)-2-fluoroethyl | 3.46^{[a]} |
| I-051 | H | Cl | H | O | 6-(trifluoromethyl)pyridin- | 2-(4-bromo-2-chlorophenyl)-2,2- | 4.51^{[b]} |
| | | | | | 2-yl | difluoroethyl | |
| I-052 | H | pyrrolidin-1-yl | H | O | 3-(trifluoromethyl)phenyl | 2-(4-chlorophenyl)-2,2-difluoroethyl | 3.81^{[a]} |
| I-053 | H | methyl | ethyl | O | 3-(trifluoromethyl)phenyl | rac-2-(2-chloro-4-methylphenyl)-2- | 3.99^{[a]} |
| | | | | | | fluoroethyl | |
| I-054 | H | Cl | H | O | 3-(trifluoromethyl)phenyl | 2-(4-bromo-2-chlorophenyl)-2,2- | 4.72^{[a]} |
| | | | | | | difluoroethyl | |
| I-055 | H | Cl | H | O | 3-hydroxyphenyl | 2-(2,4-dimethylphenyl)-2,2-difluoroethyl | 3.29^{[a]} |
| I-056 | H | Cl | vinyl | O | 3-(trifluoromethyl)phenyl | 2-(2,4-dimethylphenyl)ethyl | 4.46^{[a]} |
| I-057 | H | CF3 | H | O | 3-(trifluoromethyl)phenyl | rac-2-(4-bromo-2-chlorophenyl)-2- | 4.90^{[a]} |
| | | | | | | fluoroethyl | |
| I-058 | H | H | H | O | 3-(trifluoromethyl)phenyl | rac-2-(2,4-dichlorophenyl)-2-fluoroethyl | 3.85^{[a]} |
| I-059 | H | Cl | H | O | 3-(trifluoromethyl)phenyl | 2-(2,6-dichloropyridin-3-yl)-2,2- | 3.85^{[a]} |
| | | | | | | difluoroethyl | |
| I-060 | H | H | H | O | 3-(trifluoromethyl)phenyl | 2-(2,4-dimethoxyphenyl)ethyl | 3.21^{[a]} |
| I-061 | H | Cl | H | O | 3-(trifluoromethyl)phenyl | 2-[3-(trifluoromethyl)phenyl]propan-2-yl | 4.41^{[a]} |
| I-062 | H | Cl | methyl | O | 3-cyclopropylphenyl | rac-2-(2,4-dichlorophenyl)-2-fluoroethyl | 4.46^{[a]} |
| I-063 | H | Cl | methyl | O | 3-cyclopropylphenyl | 2-(2,4-dimethylphenyl)-2,2-difluoroethyl | 4.44^{[a]} |
| I-064 | H | Cl | (2-methyl-2- | O | 3-(trifluoromethyl)phenyl | 2-(2,4-dimethylphenyl)-2,2-difluoroethyl | 6.32^{[a]} |
| | | | trimethylsilyloxy- | | | | |
| | | | propyl)amino | | | | |
| I-065 | H | Cl | H | O | 3-[rac-2,2- | 2-(2,4-dimethylphenyl)-2,2-difluoroethyl | 4.39^{[a]} |
| | | | | | difluorocyclopropyl]phenyl | | |
| I-066 | H | methoxy | H | O | 3-(trifluoromethyl)phenyl | 1-(4-chlorophenyl)ethyl | 4.03^{[a]} |
| I-067 | H | Cl | H | O | 3-(trifluoromethyl)phenyl | 2-(2,4-difluorophenyl)-2,2-difluoroethyl | 3.75^{[a]} |
| I-068 | H | Cl | H | O | 3-(trifluoromethyl)phenyl | 2-[5-(trifluoromethyl)pyridin-2-yl]ethyl | 3.53^{[a]} |
| I-069 | H | H | H | O | 3-(trifluoromethyl)phenyl | rac-2-chloro-4,5,6,7-tetrahydro-1- | 3.96^{[a]} |
| | | | | | | benzothiophen-7-yl | |
| I-070 | H | Cl | 2-methoxyethyl | O | 3-(trifluoromethyl)phenyl | 2-(4-bromo-2-chlorophenyl)-2,2- | 4.77^{[a]} |
| | | | | | | difluoroethyl | |
| I-071 | H | H | H | O | 3-(trifluoromethyl)phenyl | 2-(5-chloropyridin-2-yl)-2,2-difluoroethyl | 3.13^{[a]} |
| I-072 | H | Cl | methylsulfinyl | O | 3-(trifluoromethyl)phenyl | 2-(2,4-dimethylphenyl)-2,2-difluoroethyl | 3.75^{[a]} |
| I-073 | H | Cl | H | O | 3-(trifluoromethyl)phenyl | 2-(3,5-dichloropyridin-2-yl)-2,2- | 4.05^{[a]} |
| | | | | | | difluoroethyl | |
| I-074 | H | methyl | methyl | O | 3-(trifluoromethyl)phenyl | rac-2-(4-bromo-2-chlorophenyl)-2- | 3.90^{[a]} |
| | | | | | | fluoroethyl | |
| I-075 | H | Cl | H | O | 3-(trifluoromethyl)phenyl | 2-(2,4-dichlorophenyl)propyl | 4.68^{[a]} |
| I-076 | H | Cl | pyridin-4-yl | O | 3-(trifluoromethyl)phenyl | 2-(2,4-dimethylphenyl)-2,2-difluoroethyl | 3.92^{[a]} |
| I-077 | H | Cl | [acetyl(methyl) | O | 3-(trifluoromethyl)phenyl | 2-(2,4-dimethylphenyl)ethyl | 3.65^{[a]} |
| | | | amino]methyl | | | | |
| I-078 | H | Cl | methylsulfonyl | O | 3-(trifluoromethyl)phenyl | 2-(2,4-dimethylphenyl)-2,2-difluoroethyl | 4.03^{[a]} |
| I-079 | H | Cl | H | O | 3-(trifluoromethyl)phenyl | [1-(2,4-dichlorophenyl)cyclopropyl]methyl | 4.85^{[a]} |
| I-080 | H | Cl | H | O | 3-methylsulfanylphenyl | rac-2-(2,4-dichlorophenyl)-2-fluoroethyl | 4.41^{[a]} |
| I-081 | H | Cl | vinyl | O | 3-(trifluoromethyl)phenyl | 2-(2,4-dimethylphenyl)-2,2-difluoroethyl | 4.56^{[a]} |
| I-082 | H | CF3 | H | O | 3-(trifluoromethyl)phenyl | 2-(2,4-dimethylphenyl)-2,2-difluoroethyl | 4.74^{[a]} |
| I-083 | H | Cl | I | O | 3-(trifluoromethyl)phenyl | 2-(4-chlorophenyl)-2,2-difluoroethyl | 4.34^{[a]} |
| I-084 | H | methyl | H | O | 3-(trifluoromethyl)phenyl | rac-1-(1-methyl-1H-indol-3-yl)ethyl | 3.55^{[a]} |
| I-085 | H | Cl | methyl | O | 3-(trifluoromethyl)phenyl | rac-2-(2,4-dichlorophenyl)-2-fluoroethyl | 4.44^{[a]} |
| I-086 | H | Cl | H | O | 3-[rac-2,2- | rac-2-(2,4-dichlorophenyl)-2-fluoroethyl | 4.44^{[a]} |
| | | | | | difluorocyclopropyl]phenyl | | |
| I-087 | H | Cl | H | O | 3-(trifluoromethyl)phenyl | 2-[2-chloro-4-(2,2,2- | 4.45^{[a]} |
| | | | | | | trifluoroethylthio)phenyl]-2,2-difluoroethyl | |
| I-088 | H | CN | H | O | 3-(trifluoromethyl)phenyl | 1-[3-(trifluoromethyl)phenyl]ethyl | 4.08^{[a]} |
| I-089 | H | cyclopropylamino | H | O | 3-(trifluoromethyl)phenyl | 2-(2,4-dimethylphenyl)-2,2-difluoroethyl | 3.69^{[a]} |
| I-090 | H | I | H | O | 3-(trifluoromethyl)phenyl | 2-(4-bromo-2-chlorophenyl)-2,2- | 4.85^{[a]} |
| | | | | | | difluoroethyl | |
| (*) I-091 | H | methyl | H | O | 3-(trifluoromethyl)phenyl | 1-[4-(trifluoromethyl)phenyl]ethyl | 3.83^{[a]} |
| I-092 | H | Cl | methyl | O | 3-(trifluoromethyl)phenyl | rac-2-(4-bromo-2-chlorophenyl)-2- | 4.53^{[a]} |
| | | | | | | fluoroethyl | |
| I-093 | H | Cl | 2-oxa-6- | O | 3-(trifluoromethyl)phenyl | 2-(2,4-dimethylphenyl)-2,2-difluoroethyl | 3.89^{[a]} |
| | | | azaspiro[3.3] | | | | |
| | | | heptan-6-yl | | | | |
| I-094 | H | methyl | H | S | 3-(trifluoromethyl)phenyl | 2-(2,4-dimethylphenyl)ethyl | 4.69^{[a]} |
| I-095 | H | methyl | H | O | 3-(trifluoromethyl)phenyl | [4-(trifluoromethyl)phenyl]methoxy | 3.44^{[a]} |
| I-096 | H | Cl | 1H-pyrazol-1-yl | O | 3-(trifluoromethyl)phenyl | 2-(2,4-dimethylphenyl)-2,2-difluoroethyl | 4.34^{[a]} |
| I-097 | H | Cl | H | O | 3-(trifluoromethyl)phenyl | rac-5-bromoindan-2-yl | 4.37^{[a]}; |
| | | | | | | | 4.31^{[b]} |
| (*) I-098 | H | methyl | H | O | 3-(trifluoromethyl)phenyl | 1-[4-(trifluoromethyl)phenyl]ethyl | 3.83^{[a]} |
| I-099 | H | Cl | H | O | 3-(trifluoromethyl)phenyl | 2,2-difluoro-2-(5-methylpyridin-2-yl)ethyl | 3.46^{[a]} |
| I-100 | H | Cl | OH | O | 3-(trifluoromethyl)phenyl | 2-(4-chlorophenyl)-2,2-difluoroethyl | 4.01^{[a]} |
| I-101 | H | methyl | H | O | 3-(difluoromethyl)phenyl | 2-(4-chlorophenyl)-2,2-difluoroethyl | 3.41^{[a]} |
| I-102 | H | methyl | H | O | 3-(trifluoromethyl)phenyl | rac-7-chloro-6-fluoro-2,2-dimethyl- | 4.41^{[a]} |
| | | | | | | chroman-4-yl | |
| I-103 | H | Cl | H | O | 3-bicyclo[4.2.0]octa- | 2-(2,4-dimethylphenyl)-2,2-difluoroethyl | 4.56^{[a]} |
| | | | | | 1(6),2,4-trienyl | | |
| I-104 | H | Cl | cyclopropyl | O | 3-(trifluoromethyl)phenyl | 2-(4-chlorophenyl)-2,2-difluoroethyl | 4.37^{[a]} |
| I-105 | H | dimethylamino | H | O | 3-(trifluoromethyl)phenyl | rac-2-(4-bromo-2-chlorophenyl)-2- | 4.21^{[a]} |
| | | | | | | fluoroethyl | |
| I-106 | H | Cl | 1,3-thiazol-4-yl | O | 3-(trifluoromethyl)phenyl | 2-(2,4-dimethylphenyl)-2,2-difluoroethyl | 4.25^{[a]} |
| I-107 | H | methyl | H | O | 3-(trifluoromethyl)phenyl | rac-8-methylchroman-4-yl | 3.65^{[a]} |
| I-108 | H | Cl | H | O | 3-(trifluoromethyl)phenyl | 2-(5-chloropyridin-2-yl)-2,2-difluoroethyl | 3.65^{[a]} |
| I-109 | H | Cl | H | O | 3-(trifluoromethyl)phenyl | rac-2-(2,4-dimethylphenyl)cyclopropyl | 4.56^{[a]} |
| I-110 | H | Cl | 1H-imidazol-1-yl | O | 3-(trifluoromethyl)phenyl | 2-(2,4-dimethylphenyl)-2,2-difluoroethyl | 3.62^{[a]} |
| I-111 | H | dimethylamino | H | O | 3-(trifluoromethyl)phenyl | 2-(4-chlorophenyl)-2,2-difluoroethyl | 3.82^{[a]} |
| I-112 | H | methyl | H | O | 3-(trifluoromethyl)phenyl | 2-[2-chloro-4-(oxan-4-yl)phenyl]-2,2- | 3.71^{[a]} |
| | | | | | | difluoroethyl | |
| I-113 | H | Cl | H | O | 3-(trifluoromethyl)phenyl | 2-(5-bromo-3-chloropyridin-2-yl)-2,2- | 4.17^{[a]} |
| | | | | | | difluoroethyl | |
| I-114 | H | Cl | cyclopropyl | O | 3-(trifluoromethyl)phenyl | 2-(2,4-dimethylphenyl)-2,2-difluoroethyl | 4.69^{[a]} |
| I-115 | H | Cl | oxetan-3-yloxy | O | 3-(trifluoromethyl)phenyl | 2-(2,4-dimethylphenyl)-2,2-difluoroethyl | 4.21^{[a]} |
| I-116 | H | methyl | H | O | 3-(trifluoromethyl)phenyl | rac-3-(4-chlorophenyl)-1-methoxy-1- | 3.73^{[a]} |
| | | | | | | oxopropan-2-yl | |
| I-117 | H | methyl | H | O | 3-(trifluoromethyl)phenyl | rac-1-(5,6,7,8-tetrahydronaphthalen-2- | 4.41^{[a]} |
| | | | | | | yl)ethyl | |
| I-118 | H | methyl | H | O | 3-(trifluoromethyl)phenyl | rac-6-fluorothiochroman-4-yl | 3.59^{[a]} |
| I-119 | H | Cl | methoxy | O | 3-(trifluoromethyl)phenyl | 2-(2,4-dimethylphenyl)ethyl | 4.32^{[a]} |
| I-120 | H | Cl | cyclopropyl | O | 3-(trifluoromethyl)phenyl | rac-1-(4-methylphenyl)ethyl | 4.25^{[a]} |
| I-121 | H | Cl | H | O | 6-(trifluoromethyl)pyridin- | 2-(2,4-dichlorophenyl)-2,2-difluoroethyl | 4.03^{[a]}; |
| | | | | | 2-yl | | 4.18^{[b]} |
| I-122 | H | cyclopropyl | H | O | 3-(difluoromethyl)phenyl | 2-(4-bromo-2-chlorophenyl)-2,2- | 4.32^{[a]} |
| | | | | | | difluoroethyl | |
| I-123 | H | methyl | H | O | 3-(trifluoromethyl)phenyl | 2-(4-cyanophenyl)propan-2-yl | 3.21^{[a]} |
| I-124 | H | methyl | methyl | O | 2-fluoro-3- | rac-2-(4-bromo-2-chlorophenyl)-2- | 4.01^{[a]} |
| | | | | | (trifluoromethyl)phenyl | fluoroethyl | |
| I-125 | H | Cl | H | O | 4-fluoro-3- | 2-(2,4-dimethylphenyl)-2,2-difluoroethyl | 4.54^{[a]} |
| | | | | | (trifluoromethyl)phenyl | | |
| I-126 | H | Cl | cyclopropyl | O | 3-(trifluoromethyl)phenyl | 2-(2,4-dimethylphenyl)ethyl | 4.51^{[a]} |
| I-127 | H | Cl | H | O | 6-(trifluoromethyl)pyridin- | 2-(4-chlorophenyl)-2,2-difluoroethyl | 3.69^{[a]}; |
| | | | | | 2-yl | | 3.70^{[b]} |
| I-128 | H | methyl | H | O | 5-(trifluoromethyl)pyridin- | rac-2-(2,4-dichlorophenyl)-2-fluoroethyl | 3.48^{[a]}; |
| | | | | | 3-yl | | 3.55^{[b]} |
| I-129 | H | methyl | H | O | 3-(trifluoromethyl)phenyl | rac-1-(3-fluoro-4-methoxyphenyl)ethyl | 3.21^{[a]} |
| I-130 | H | Cl | 4-methyl-1H- | O | 3-(trifluoromethyl)phenyl | 2-(2,4-dimethylphenyl)-2,2-difluoroethyl | 4.54^{[a]} |
| | | | pyrazol-1-yl | | | | |
| I-131 | H | Cl | vinyl | O | 3-(trifluoromethyl)phenyl | 2-(4-chlorophenyl)-2,2-difluoroethyl | 4.32^{[a]} |
| I-132 | H | Cl | H | O | 3-(trifluoromethyl)phenyl | rac-2-(3-chlorophenyl)cyclopropyl | 4.03^{[a]} |
| I-133 | H | CN | methyl | O | 3-(trifluoromethyl)phenyl | 2-(2,4-dimethylphenyl)-2,2-difluoroethyl | 4.33^{[a]}; |
| | | | | | | | 4.44^{[b]} |
| I-134 | H | methyl | methyl | O | 2-fluoro-3- | 2-(2,4-dimethylphenyl)-2,2-difluoroethyl | 3.92^{[a]} |
| | | | | | (trifluoromethyl)phenyl | | |
| I-135 | H | oxetan-3-yl | H | O | 3-chlorophenyl | 2-(2,4-dimethylphenyl)-2,2-difluoroethyl | 3.69^{[a]} |
| I-136 | H | Cl | 2-methoxy-2- | O | 3-(trifluoromethyl)phenyl | 2-(2,4-dimethylphenyl)-2,2-difluoroethyl | 4.82^{[a]} |
| | | | methylpropoxy | | | | |
| I-137 | H | Cl | 3-(difluoromethyl)- | O | 3-(trifluoromethyl)phenyl | 2-(2,4-dimethylphenyl)-2,2-difluoroethyl | 4.61^{[a]} |
| | | | 1H-pyrazol-1-yl | | | | |
| I-138 | H | Cl | H | O | 3-methylphenyl | 1-(3-methylphenyl)ethyl | 3.76^{[a]} |
| I-139 | H | Cl | vinyl | O | 3-(trifluoromethyl)phenyl | 2-(4-bromo-2-chlorophenyl)ethyl | 4.72^{[a]} |
| I-140 | H | Cl | Cl | O | 3-(trifluoromethyl)phenyl | 2-(2,4-dimethylphenyl)-2,2-difluoroethyl | 4.67^{[a]} |
| I-141 | H | Cl | H | O | 6-(trifluoromethyl)pyridin- | rac-2-(4-bromo-2-chlorophenyl)-2- | 4.06^{[a]}; |
| | | | | | 2-yl | fluoroethyl | 4.20^{[b]} |
| (*) I-142 | H | Cl | H | O | 3-(trifluoromethyl)phenyl | 2-(4-bromo-2-chlorophenyl)-2-fluoroethyl | 4.56^{[a]}; |
| | | | | | | | 4.49^{[b]} |
| I-143 | H | methyl | H | O | 3-(trifluoromethyl)phenyl | rac-6-methoxy-1,2,3,4-tetrahydro- | 3.64^{[a]} |
| | | | | | | naphthalen-1-yl | |
| I-144 | H | Cl | ethyl | O | 3-(trifluoromethyl)phenyl | rac-2-(2,4-dichlorophenyl)-2-fluoroethyl | 4.81^{[a]} |
| I-145 | H | methyl | methyl | O | 2-fluoro-3- | 2-(2,4-dichlorophenyl)ethyl | 3.94^{[a]} |
| | | | | | (trifluoromethyl)phenyl | | |
| I-146 | H | Cl | oxetan-3-yl | O | 3-chlorophenyl | 2-(2,4-dimethylphenyl)-2,2-difluoroethyl | 3.96^{[a]} |
| (*) I-147 | H | Cl | H | O | 3-(trifluoromethyl)phenyl | 2-chloro-4,5,6,7-tetrahydro-1-benzo- | 4.71^{[a]} |
| | | | | | | thiophen-7-yl | |
| I-148 | H | cyclopropyl | cyclopropylamino | O | 3-(trifluoromethyl)phenyl | 2-(4-chlorophenyl)-2,2-difluoroethyl | 3.87^{[a]} |
| I-149 | H | CN | methyl | O | 3-(trifluoromethyl)phenyl | 2-(2,4-dichlorophenyl)-2,2-difluoroethyl | 4.42^{[a]}; |
| | | | | | | | 4.48^{[b]} |
| I-150 | H | methyl | H | O | 3-(trifluoromethyl)phenyl | rac-1-(3-bromophenyl)ethyl | 3.73^{[a]} |
| I-151 | H | ethyl | H | O | 3-(trifluoromethyl)phenyl | 2-(2,4-dimethylphenyl)-2,2-difluoroethyl | 4.46^{[a]} |
| I-152 | H | methyl | H | O | 3-(trifluoromethyl)phenyl | rac-2-(2-chloro-4-prop-1-en-2-ylphenyl)- | 4.41^{[a]}; |
| | | | | | | 2-fluoroethyl | 4.35^{[b]} |
| I-153 | H | Cl | methoxy | O | 3-cyclopropyl-2- | 2-(2,4-dimethylphenyl)-2,2-difluoroethyl | 4.49^{[a]} |
| | | | | | fluorophenyl | | |
| I-154 | H | Cl | vinyl | O | 3-(trifluoromethyl)phenyl | 2-(4-bromo-2-chlorophenyl)-2,2- | 4.77^{[a]} |
| | | | | | | difluoroethyl | |
| I-155 | H | Cl | Cl | O | 3-(trifluoromethyl)phenyl | 2,2-difluoro-2-(3-methylphenyl)ethyl | 4.34^{[a]} |
| I-156 | H | Cl | H | O | 3-(trifluoromethyl)phenyl | rac-2-(2-chlorophenyl)cyclopropyl | 4.13^{[a]} |
| I-157 | H | pyridin-4-yl | cyclopropylamino | O | 3-(trifluoromethyl)phenyl | 2-(2,4-dimethylphenyl)-2,2-difluoroethyl | 3.37^{[a]} |
| I-158 | H | Cl | H | O | 3-(difluoromethyl)phenyl | 2-(5-chloropyridin-2-yl)-2,2-difluoroethyl | 3.32^{[a]} |
| I-159 | H | methyl | H | O | 3-(trifluoromethyl)phenyl | rac-1-(6-methoxynaphthalen-2-yl)ethyl | 3.83^{[a]} |
| I-160 | H | ethyl | H | O | 3-(trifluoromethyl)phenyl | rac-2-(2,4-dichlorophenyl)-2-fluoroethyl | 4.49^{[a]} |
| I-161 | H | Cl | 3-[rac-oxolan-2-yl]- | O | 3-(trifluoromethyl)phenyl | 2-(2,4-dimethylphenyl)-2,2-difluoroethyl | 4.51^{[a]} |
| | | | 1H-pyrazol-1-yl | | | | |
| I-162 | H | Cl | methoxy | O | 3-(trifluoromethyl)phenyl | 2-(2,4-dimethylphenyl)-2,2-difluoroethyl | 4.44^{[a]} |
| I-163 | H | Cl | ethoxy | O | 3-(trifluoromethyl)phenyl | 2,2-difluoro-2-(3-fluorophenyl)ethyl | 4.11^{[a]} |
| I-164 | H | acetyl | H | O | 3-(trifluoromethyl)phenyl | 2-(4-bromo-2-chlorophenyl)-2,2- | 4.54^{[a]} |
| | | | | | | difluoroethyl | |
| I-165 | H | Cl | H | O | 3-bromo-2-fluorophenyl | rac-2-(2,4-dichlorophenyl)-2-fluoroethyl | 4.46^{[a]} |
| I-166 | H | methyl | H | O | 3-(trifluoromethyl)phenyl | rac-1-(3,4-difluorophenyl)ethyl | 3.39^{[a]} |
| I-167 | H | methyl | H | O | 3-(trifluoromethyl)phenyl | rac-6-methyl-3,4-dihydro-1H-isochromen- | 3.31^{[a]} |
| | | | | | | 4-yl | |
| I-168 | H | Cl | methoxy | O | 3-(trifluoromethyl)phenyl | 2-(4-chlorophenyl)-2,2-difluoroethyl | 4.18^{[a]} |
| I-169 | H | Cl | vinyl | O | 3-(trifluoromethyl)phenyl | rac-1-(4-methylphenyl)ethyl | 4.15^{[a]} |
| I-170 | H | Cl | H | O | 3-(trifluoromethyl)phenyl | 2-(4-cyano-2-methylphenyl)ethyl | 3.37^{[a]} |
| I-171 | H | methyl | H | S | 3-(trifluoromethyl)phenyl | 2-(2,4-dimethylphenyl)-2,2-difluoroethyl | 4.69^{[a]} |
| I-172 | H | methyl | H | O | 3-(difluoromethyl)phenyl | 2-(4-bromo-2-chlorophenyl)-2,2- | 3.85^{[a]} |
| | | | | | | difluoroethyl | |
| I-173 | H | Cl | H | O | 5-bromopyridin-3-yl | 2-(2,4-dimethylphenyl)-2,2-difluoroethyl | 3.78^{[a]} |
| I-174 | H | Cl | ethoxy | O | 3-(trifluoromethyl)phenyl | 2-(4-chlorophenyl)-2,2-difluoroethyl | 4.41^{[a]} |
| I-175 | H | Cl | H | O | 3-cyclopropyl-2- | rac-2-(2,4-dichlorophenyl)-2-fluoroethyl | 4.80^{[a]} |
| | | | | | fluorophenyl | | |
| I-176 | H | methyl | H | O | 3-(difluoromethyl)phenyl | 2-(2,4-dimethylphenyl)-2,2-difluoroethyl | 3.68^{[a]} |
| I-177 | H | Cl | ethoxy | O | 3-(trifluoromethyl)phenyl | 2,2-difluoro-2-(3-methylphenyl)ethyl | 4.34^{[a]} |
| I-178 | H | Cl | H | O | 3-(oxetan-3-yl)phenyl | 2-(4-bromo-2-chlorophenyl)-2,2- | 3.83^{[a]} |
| | | | | | | difluoroethyl | |
| I-179 | H | methyl | H | O | 3-bromophenyl | 2-(4-bromo-2-chlorophenyl)-2,2- | 4.16^{[a]} |
| | | | | | | difluoroethyl | |
| I-180 | H | cyclopropyl | H | O | 3-(trifluoromethyl)phenyl | 2-(2,4-dimethylphenyl)-2,2-difluoroethyl | 4.51^{[a]}; |
| | | | | | | | 4.47^{[b]} |
| I-181 | H | Cl | ethoxy | O | 3-(trifluoromethyl)phenyl | 2-(2,4-dimethylphenyl)-2,2-difluoroethyl | 4.68^{[a]} |
| I-182 | H | Cl | H | O | 3-(difluoromethyl)phenyl | 2-(4-bromophenyl)-2,2-difluoroethyl | 3.92^{[a]} |
| I-183 | H | H | methyl | O | 3-(trifluoromethyl)phenyl | 2-(2,4-dichlorophenyl)-2,2-difluoroethyl | 3.78^{[a]} |
| I-184 | H | methyl | H | O | 3-(trifluoromethyl)phenyl | rac-1-(1,3-benzodioxol-5-yl)ethyl | 3.13^{[a]} |
| I-185 | H | Cl | H | O | 3-(oxetan-3-yl)phenyl | rac-2-(2,4-dichlorophenyl)-2-fluoroethyl | 3.64^{[a]} |
| I-186 | H | Cl | [rac-1-methoxy- | O | 3-(trifluoromethyl)phenyl | 2-(2,4-dimethylphenyl)-2,2-difluoroethyl | 4.76^{[a]} |
| | | | propan-2-yl]oxy | | | | |
| I-187 | H | Cl | H | O | 3-cyclopropyl-2- | 2-(2,4-dimethylphenyl)-2,2-difluoroethyl | 4.72^{[a]} |
| | | | | | fluorophenyl | | |
| I-188 | H | Cl | methyl | O | 3-(trifluoromethyl)phenyl | 2-(7-methoxy-2-methyl-1-benzofuran-4- | 3.90^{[a]} |
| | | | | | | yl)ethyl | |
| I-189 | H | Cl | oxetan-3-ylamino | O | 3-cyclopropyl-2- | 2-(2,4-dimethylphenyl)-2,2-difluoroethyl | 3.90^{[a]} |
| | | | | | fluorophenyl | | |
| I-190 | H | methyl | H | O | 3-bromophenyl | 2-(2,4-dimethylphenyl)-2,2-difluoroethyl | 4.01^{[a]} |
| I-191 | H | methyl | H | O | 2-fluoro-3- | 2-(2,4-dimethylphenyl)-2,2-difluoroethyl | 4.11^{[a]} |
| | | | | | (trifluoromethyl)phenyl | | |
| I-192 | H | Cl | ethoxy | O | 3-(trifluoromethyl)phenyl | 2-(4-bromo-2-chlorophenyl)-2,2- | 4.86^{[a]} |
| | | | | | | difluoroethyl | |
| I-193 | H | methyl | H | O | 2-fluoro-3- | 2-(4-bromo-2-chlorophenyl)-2,2- | 4.49^{[a]} |
| | | | | | (trifluoromethyl)phenyl | difluoroethyl | |
| I-194 | H | methyl | H | O | 3-(difluoromethyl)phenyl | rac-2-(4-bromo-2-chlorophenyl)-2- | 3.72^{[a]} |
| | | | | | | fluoroethyl | |
| (*) I-195 | H | methyl | H | O | 3-(trifluoromethyl)phenyl | rac-1-(2,3-dihydro-1-benzofuran-5-yl)ethyl | 3.19^{[a]} |
| I-196 | H | ethyl | H | O | 3-(trifluoromethyl)phenyl | rac-2-(4-bromo-2-chlorophenyl)-2- | 4.66^{[a]} |
| | | | | | | fluoroethyl | |
| I-197 | H | Cl | (2-methyl-1,3- | O | 3-cyclopropyl-2- | 2-(2,4-dimethylphenyl)-2,2-difluoroethyl | 4.41^{[a]} |
| | | | dioxolan-4-yl) | | fluorophenyl | | |
| | | | methyl-amino | | | | |
| I-198 | H | methyl | H | O | 3-chlorophenyl | 2-(4-bromo-2-chlorophenyl)-2,2- | 4.11^{[a]} |
| | | | | | | difluoroethyl | |
| I-199 | H | Cl | ethoxy | O | 3-(trifluoromethyl)phenyl | rac-1-(4-methylphenyl)ethyl | 4.25^{[a]} |
| I-200 | H | methyl | H | O | 2-fluoro-3- | 2-(2,4-dichlorophenyl)-2,2-difluoroethyl | 4.19^{[a]} |
| | | | | | (trifluoromethyl)phenyl | | |
| I-201 | H | 1-hydrazinylidene- | H | O | 3-(trifluoromethyl)phenyl | rac-2-(4-bromo-2-chlorophenyl)-2- | 4.18^{[a]} |
| | | ethyl | | | | fluoroethyl | |
| I-202 | H | Cl | 3-hydroxyazetidin- | O | 3-(trifluoromethyl)phenyl | 2-(4-chlorophenyl)-2,2-difluoroethyl | 3.31^{[a]} |
| | | | 1-yl | | | | |
| I-203 | H | Cl | H | O | 3-(difluoromethyl)phenyl | rac-2-(4-bromo-2-chlorophenyl)-2- | 4.23^{[a]} |
| | | | | | | fluoroethyl | |
| I-204 | H | Cl | methyl | O | 3-(difluoromethyl)phenyl | 2-(4-chlorophenyl)-2,2-difluoroethyl | 3.79^{[a]} |
| I-205 | H | methyl | H | O | 3-(trifluoromethyl)phenyl | rac-1-(3,4-dimethylphenyl)ethyl | 3.89^{[a]} |
| I-206 | H | methyl | H | O | 3-(trifluoromethyl)phenyl | rac-1-(5-chloro-2,3-dihydro-1-benzo- | 3.96^{[a]} |
| | | | | | | furan-7-yl)ethyl | |
| I-207 | H | Cl | oxan-4-yl | O | 3-(trifluoromethyl)phenyl | 2-(2,4-dimethylphenyl)-2,2-difluoroethyl | 4.17^{[a]} |
| I-208 | H | Cl | H | O | 3-(trifluoromethyl)phenyl | 6-methyl-1,2,3,4-tetrahydronaphthalen- | 4.59^{[a]}; |
| | | | | | | 2-yl | 4.48^{[b]} |
| I-209 | H | Cl | H | O | 3-chloro-2-fluorophenyl | 2-(2,4-dimethylphenyl)-2,2-difluoroethyl | 4.44^{[a]} |
| I-210 | H | methyl | H | O | 3-(trifluoromethyl)phenyl | 1-[(4-methylphenyl)methyl]cyclopropyl | 3.73^{[a]} |
| I-211 | H | Cl | methylamino | O | 3-(trifluoromethyl)phenyl | 2-(4-chlorophenyl)-2,2-difluoroethyl | 3.68^{[a]} |
| I-212 | H | Cl | H | O | 3-(difluoromethyl)phenyl | rac-2-(2,4-dichlorophenyl)-2-fluoroethyl | 4.13^{[a]} |
| I-213 | H | methyl | H | O | 3-(trifluoromethyl)phenyl | rac-1-(3-chlorophenyl)ethyl | 3.60^{[a]} |
| I-214 | H | methyl | H | O | 3-(trifluoromethyl)phenyl | 1-(2-methyl-2,3-dihydrobenzofuran-5- | 3.46^{[a]} |
| | | | | | | yl)ethyl | |
| I-215 | H | Cl | methyl | O | 3-cyclopropyl-2- | 2-(2,4-dichlorophenyl)ethyl | 4.58^{[a]} |
| | | | | | fluorophenyl | | |
| I-216 | H | Cl | 4-(ethoxycarbonyl)- | O | 3-(trifluoromethyl)phenyl | 2-(2,4-dimethylphenyl)-2,2-difluoroethyl | 4.69^{[a]} |
| | | | 1H-pyrazol-1-yl | | | | |
| I-217 | H | ethyl | methyl | O | 3-(trifluoromethyl)phenyl | 2-(2,4-dimethylphenyl)-2,2-difluoroethyl | 4.05^{[a]} |
| I-218 | H | methyl | H | O | 3-chlorophenyl | 2-(2,4-dimethylphenyl)-2,2-difluoroethyl | 3.92^{[a]} |
| I-219 | H | Cl | H | O | 3-bromo-2-fluorophenyl | 2-(2,4-dimethylphenyl)-2,2-difluoroethyl | 4.49^{[a]} |
| I-220 | H | CN | H | O | 3-(trifluoromethyl)phenyl | 2-(2,4-dimethylphenyl)-2,2-difluoroethyl | 4.34^{[a]} |
| I-221 | H | Cl | ethoxy | O | 3-(trifluoromethyl)phenyl | 2-(2,4-dimethylphenyl)ethyl | 4.53^{[a]} |
| I-222 | H | prop-1-en-2-yl | H | O | 3-(trifluoromethyl)phenyl | 2-(2,4-dimethylphenyl)-2,2-difluoroethyl | 4.87^{[a]} |
| I-223 | H | methyl | H | O | 2-fluoro-3- | rac-2-(4-chlorophenyl)-2-fluoroethyl | 3.71^{[a]} |
| | | | | | (trifluoromethyl)phenyl | | |
| I-224 | H | methyl | H | O | 3-(trifluoromethyl)phenyl | 1-(4-chlorophenyl)-2-methylpropan-2-yl | 4.32^{[a]} |
| I-225 | H | Cl | 2-hydroxyethyl- | O | 3-(trifluoromethyl)phenyl | 2-(4-chlorophenyl)-2,2-difluoroethyl | 3.29^{[a]} |
| | | | amino | | | | |
| I-226 | H | methyl | H | O | 3-(difluoromethyl)phenyl | 2-(4-bromophenyl)-2,2-difluoroethyl | 3.46^{[a]} |
| I-227 | H | methyl | H | O | 3-(trifluoromethyl)phenyl | rac-1-(3,4-dichlorophenyl)ethyl | 3.99^{[a]} |
| I-228 | H | 1H-imidazol-1-yl | H | O | 3-(trifluoromethyl)phenyl | rac-2-(4-bromo-2-chlorophenyl)-2- | 3.31^{[a]}; |
| | | | | | | fluoroethyl | 4.06^{[b]} |
| (*) I-229 | H | methyl | H | O | 3-(trifluoromethyl)phenyl | 1-(2,3-dihydro-1-benzofuran-5-yl)ethyl | 3.17^{[a]} |
| I-230 | H | Cl | 5-cyclopropyl-1H- | O | 3-(trifluoromethyl)phenyl | 2-(2,4-dimethylphenyl)-2,2-difluoroethyl | 4.82^{[a]} |
| | | | pyrazol-1-yl | | | | |
| I-231 | H | Cl | H | O | 3-(trifluoromethyl)phenyl | 2-(2,4-dimethylphenyl)ethyl | 4.51^{[a]} |
| I-232 | H | Cl | H | O | 3-aminophenyl | 2-(2,4-dimethylphenyl)-2,2-difluoroethyl | 3.23^{[a]} |
| (*) I-233 | H | methyl | H | O | 2-fluoro-3- | rac-2-(4-bromo-2-chlorophenyl)-2- | 4.24^{[a]} |
| | | | | | (trifluoromethyl)phenyl | fluoroethyl | |
| I-234 | H | Cl | 2-hydroxyethyl- | O | 3-(trifluoromethyl)phenyl | 2-(2,4-dimethylphenyl)-2,2-difluoroethyl | 3.48^{[a]} |
| | | | amino | | | | |
| I-235 | H | methyl | H | O | 3-(difluoromethyl)phenyl | 2-(5-chloropyridin-2-yl)-2,2-difluoroethyl | 2.92^{[a]} |
| I-236 | H | methyl | H | O | 3-(trifluoromethyl)phenyl | rac-1-(6-methylnaphthalen-2-yl)ethyl | 4.23^{[a]} |
| I-237 | H | Cl | 4-cyano-1H- | O | 3-(trifluoromethyl)phenyl | 2-(2,4-dimethylphenyl)-2,2-difluoroethyl | 4.32^{[a]} |
| | | | pyrazol-1-yl | | | | |
| I-238 | H | Cl | methylsulfanyl | O | 3-(trifluoromethyl)phenyl | 2-(2,4-dimethylphenyl)-2,2-difluoroethyl | 4.56^{[a]} |
| I-239 | H | Cl | H | O | 3-(trifluoromethyl)phenyl | 2-(4-chlorophenyl)-2-fluoroethyl | 3.99^{[a]}; |
| | | | | | | | 3.94^{[b]} |
| I-240 | H | Cl | H | O | 3-(trifluoromethyl)phenyl | 2-(4-cyclopropyl-2-methylphenyl)-2,2- | 4.77^{[a]} |
| | | | | | | difluoroethyl | |
| I-241 | H | Cl | cyclohexylamino | O | 3-(trifluoromethyl)phenyl | 2-(2,4-dimethylphenyl)-2,2-difluoroethyl | 5.27^{[a]} |
| I-242 | H | methyl | H | O | 3-(difluoromethyl)phenyl | rac-2-(2,4-dichlorophenyl)-2-fluoroethyl | 3.63^{[a]} |
| I-243 | H | Cl | H | O | 3-(trifluoromethyl)phenyl | 2-(2-cyano-4-methylphenyl)ethyl | 4.33^{[a]} |
| I-244 | H | methyl | H | O | 3-(trifluoromethyl)phenyl | rac-1-(4-bromophenyl)ethyl | 3.76^{[a]} |
| (*) I-245 | H | Cl | H | O | 3-(trifluoromethyl)phenyl | 6-methyl-1,2,3,4-tetrahydronaphthalen- | 4.61^{[a]}; |
| | | | | | | 1-yl | 4.51^{[b]} |
| I-246 | H | methyl | H | O | 3-(trifluoromethyl)phenyl | 2-(2,5-difluorophenyl)ethyl | 3.35^{[a]} |
| I-247 | H | Cl | H | O | 3-cyclopropylphenyl | 2-(4-chlorophenyl)-2,2-difluoroethyl | 4.41^{[a]} |
| I-248 | H | methyl | H | O | 2-fluoro-3- | 2-(4-chlorophenyl)-2,2-difluoroethyl | 4.18^{[a]} |
| | | | | | (trifluoromethyl)phenyl | | |
| I-249 | H | Cl | 1H-pyrazol-1-yl | O | 3-(trifluoromethyl)phenyl | 2-(4-chlorophenyl)-2,2-difluoroethyl | 4.13^{[a]} |
| I-250 | H | Cl | 3-chloropyridin- | O | 3-(trifluoromethyl)phenyl | 2-(2,4-dimethylphenyl)-2,2-difluoroethyl | 4.49^{[a]} |
| | | | 4-yl | | | | |
| I-251 | H | cyclopropyl | H | O | 3-(difluoromethyl)phenyl | 2-(5-chloropyridin-2-yl)-2,2-difluoroethyl | 3.46^{[a]} |
| I-252 | H | 1H-imidazol-1-yl | H | O | 3-(trifluoromethyl)phenyl | rac-2-(2,4-dichlorophenyl)-2-fluoroethyl | 3.23^{[a]}; |
| | | | | | | | 3.99^{[b]} |
| I-253 | H | Cl | H | O | 3-(trifluoromethyl)phenyl | rac-1-[3-(trifluoromethyl)phenyl]ethyl | 4.24^{[a]} |
| I-254 | H | Cl | ethyl | O | 3-(trifluoromethyl)phenyl | 2-(4-chlorophenyl)-2,2-difluoroethyl | 4.51^{[a]} |
| (*) I-255 | H | cyclopropyl | H | O | 3-(trifluoromethyl)phenyl | rac-2-(4-bromo-2-chlorophenyl)-2- | 4.80^{[a]} |
| | | | | | | fluoroethyl | |
| I-256 | H | Cl | dimethylamino | O | 3-(trifluoromethyl)phenyl | 2-(2,4-dimethylphenyl)-2,2-difluoroethyl | 4.41^{[a]} |
| I-257 | H | Cl | (4-methoxy-4- | O | 3-(trifluoromethyl)phenyl | 2-(2,4-dimethylphenyl)-2,2-difluoroethyl | 4.23^{[a]} |
| | | | oxobutyl)amino | | | | |
| I-258 | H | cyclopropyl | H | O | 3-(difluoromethyl)phenyl | rac-2-(4-bromo-2-chlorophenyl)-2- | 4.27^{[a]} |
| | | | | | | fluoroethyl | |
| I-259 | H | Cl | H | O | phenyl | 2-(2,4-dichlorophenyl)-2,2-difluoroethyl | 4.11^{[a]} |
| I-260 | H | Cl | H | O | 2-fluoro-3- | 2-(2,4-dimethylphenyl)-2,2-difluoroethyl | 4.54^{[a]} |
| | | | | | (trifluoromethyl)phenyl | | |
| I-261 | H | Cl | H | O | 3-(trifluoromethyl)phenyl | rac-1-(4-methylphenyl)ethyl | 4.15^{[a]} |
| I-262 | H | Cl | pyrrolidin-1-yl | O | 3-(trifluoromethyl)phenyl | 2-(2,4-dimethylphenyl)-2,2-difluoroethyl | 4.56^{[a]} |
| I-263 | H | cyclopropyl | H | O | 3-(difluoromethyl)phenyl | 2-(4-chlorophenyl)-2,2-difluoroethyl | 3.87^{[a]} |
| I-264 | H | methyl | H | O | 3-(difluoromethyl)-2- | 2-(4-chlorophenyl)-2,2-difluoroethyl | 3.50^{[a]} |
| | | | | | fluorophenyl | | |
| I-265 | H | Cl | 2-methoxyethoxy- | O | 3-chlorophenyl | 2-(2,4-dimethylphenyl)-2,2-difluoroethyl | 4.20^{[a]} |
| | | | methyl | | | | |
| I-266 | H | methyl | methyl | O | 3-chlorophenyl | 2-(4-methylphenyl)propan-2-yl | 3.39^{[a]} |
| (*) I-267 | H | Cl | methyl | O | 3-cyclopropyl-2- | rac-2-(2,4-dichlorophenyl)-2-fluoroethyl | 4.59^{[a]} |
| | | | | | fluorophenyl | | |
| I-268 | H | Cl | H | O | 3-(trifluoromethyl)phenyl | 2-(3,4-dimethoxyphenyl)ethyl | 3.26^{[a]} |
| I-269 | H | Cl | phenyl | O | 3-(trifluoromethyl)phenyl | 2-(2,4-dimethylphenyl)-2,2-difluoroethyl | 4.85^{[a]} |
| I-270 | H | Cl | H | O | 3-(trifluoromethyl)phenyl | 2-(2,4-difluorophenyl)ethyl | 3.85^{[a]}; |
| | | | | | | | 3.79^{[b]} |
| I-271 | H | Cl | 1H-imidazol-1-yl | O | 3-(trifluoromethyl)phenyl | 2-(4-chlorophenyl)-2,2-difluoroethyl | 3.44^{[a]} |
| I-272 | H | Cl | cyclohexylamino | O | 3-(trifluoromethyl)phenyl | 2-(4-chlorophenyl)-2,2-difluoroethyl | 4.98^{[a]} |
| I-273 | H | Cl | H | O | 3-(difluoromethyl)phenyl | 2-(4-bromo-2-chlorophenyl)-2,2- | 4.25^{[a]} |
| | | | | | | difluoroethyl | |
| I-274 | H | Cl | H | O | 3-(trifluoromethyl)phenyl | rac-7-bromo-1,2,3,4-tetrahydronaphthalen- | 4.51^{[a]} |
| | | | | | | 1-yl | |
| I-275 | H | 3-chloropyridin- | H | O | 3-(difluoromethyl)-2- | 2-(2,4-dimethylphenyl)-2,2-difluoroethyl | 4.11^{[a]} |
| | | 4-yl | | | fluorophenyl | | |
| I-276 | H | Cl | H | O | 3-(trifluoromethyl)phenyl | rac-2-(4-chlorophenyl)cyclopropyl | 3.89^{[a]} |
| I-277 | H | Cl | H | O | 3-(trifluoromethyl)phenyl | 2,2-difluoro-2-(3-methylphenyl)ethyl | 4.23^{[a]} |
| I-278 | H | Cl | H | O | 3-(trifluoromethyl)phenyl | 2,2-difluoro-2-[4-[4- | 4.85^{[a]} |
| | | | | | | (methoxycarbonyl)phenyl]-2- | |
| | | | | | | methylphenyl]ethyl | |
| I-279 | H | methyl | methyl | O | 3-(trifluoromethyl)phenyl | 2-(4-chlorophenyl)-2,2-difluoroethyl | 3.60^{[a]} |
| I-280 | H | Cl | anilino | O | 3-(trifluoromethyl)phenyl | 2-(4-chlorophenyl)-2,2-difluoroethyl | 4.23^{[a]} |
| I-281 | H | cyclopropyl | H | O | 3-(difluoromethyl)phenyl | 2-(4-bromophenyl)-2,2-difluoroethyl | 3.99^{[a]} |
| I-282 | H | methyl | H | O | 3-cyclopropylphenyl | 2-[5-(difluoromethyl)pyridin-2-yl]ethyl | 2.82^{[b]} |
| I-283 | H | methyl | H | O | 3-(difluoromethyl)-2- | 2-(4-bromo-2-chlorophenyl)-2,2- | 3.94^{[a]} |
| | | | | | fluorophenyl | difluoroethyl | |
| I-284 | H | methyl | methyl | O | 3-cyclopropyl-2- | rac-2-(4-bromo-2-chlorophenyl)-2- | 4.01^{[a]} |
| | | | | | fluorophenyl | fluoroethyl | |
| I-285 | H | Cl | [rac-1-hydroxy-3- | O | 3-(trifluoromethyl)phenyl | 2-(2,4-dimethylphenyl)-2,2-difluoroethyl | 3.90^{[a]} |
| | | | methoxypropan-2- | | | | |
| | | | yl]oxy | | | | |
| I-286 | H | Cl | H | O | 3-(trifluoromethyl)phenyl | 2-(2,5-difluorophenyl)ethyl | 3.82^{[a]} |
| I-287 | H | Cl | H | O | 3-chloro-5-fluorophenyl | 2-(2,4-dimethylphenyl)-2,2-difluoroethyl | 4.59^{[a]} |
| (*) I-288 | H | cyclopropyl | H | O | 3-(trifluoromethyl)phenyl | rac-2-(2,4-dichlorophenyl)-2-fluoroethyl | 4.57^{[a]} |
| I-289 | H | Cl | dimethylamino | O | 3-(trifluoromethyl)phenyl | 2-(4-chlorophenyl)-2,2-difluoroethyl | 4.15^{[a]} |
| I-290 | H | cyclopropyl | H | O | 3-(difluoromethyl)phenyl | 2-(2,4-dimethylphenyl)-2,2-difluoroethyl | 4.15^{[a]} |
| I-291 | H | Cl | H | O | 5-(trifluoromethyl)-3-thienyl | 2-(2,4-dimethylphenyl)ethyl | 4.55^{[a]} |
| I-292 | H | CN | H | O | 3-(trifluoromethyl)phenyl | 2-(4-chlorophenyl)-2,2-difluoroethyl | 4.08^{[a]} |
| I-293 | H | Cl | 2-methoxyethyl | O | 3-(trifluoromethyl)phenyl | 2-(2,4-dimethylphenyl)ethyl | 4.51^{[a]} |
| I-294 | H | methoxy | methyl | O | 3-(trifluoromethyl)phenyl | 2-(2,4-dimethylphenyl)-2,2-difluoroethyl | 4.34^{[a]} |
| I-295 | H | cyclopropyl | H | O | 3-(difluoromethyl)phenyl | rac-2-(2,4-dichlorophenyl)-2-fluoroethyl | 4.18^{[a]} |
| I-296 | H | Cl | methyl | O | 3-(trifluoromethyl)phenyl | 2-(4-methylphenyl)propan-2-yl | 4.20^{[a]} |
| I-297 | H | Cl | H | O | 3-(trifluoromethyl)phenyl | 2-(4-bromophenyl)-2-fluoroethyl | 4.13^{[a]}; |
| | | | | | | | 4.08^{[b]} |
| I-298 | H | CN | H | O | 3-(trifluoromethyl)phenyl | 2-(4-bromo-2-chlorophenyl)-2,2- | 4.49^{[a]} |
| | | | | | | difluoroethyl | |
| I-299 | H | Cl | H | O | 3-(trifluoromethyl)phenyl | 2,2-difluoro-2-[2-methyl-4-(1-methyl-1H- | 3.60^{[a]} |
| | | | | | | pyrazol-4-yl)phenyl]ethyl | |
| I-300 | H | Cl | H | O | 2-fluoro-3- | 2-(4-chlorophenyl)-2,2-difluoroethyl | 4.26^{[a]} |
| | | | | | (trifluoromethyl)phenyl | | |
| I-301 | H | Cl | methylamino | O | 3-(trifluoromethyl)phenyl | 2-(2,4-dimethylphenyl)-2,2-difluoroethyl | 3.90^{[a]} |
| I-302 | H | methyl | H | O | 3-(trifluoromethyl)phenyl | rac-1-(4-fluorophenyl)ethyl | 3.29^{[a]} |
| I-303 | H | Cl | ethyl | O | 3-(trifluoromethyl)phenyl | rac-2-(4-bromo-2-chlorophenyl)-2- | 4.88^{[a]} |
| | | | | | | fluoroethyl | |
| I-304 | H | methyl | methyl | O | 3-(difluoromethyl)-2- | 2-(4-bromo-2-chlorophenyl)-2,2- | 3.72^{[a]} |
| | | | | | fluorophenyl | difluoroethyl | |
| I-305 | H | methyl | H | O | 3-nitrophenyl | 2-(4-bromo-2-chlorophenyl)-2,2- | 3.62^{[a]} |
| | | | | | | difluoroethyl | |
| I-306 | H | Cl | H | O | 3-(trifluoromethyl)phenyl | quinolin-3-ylmethyl | 2.71^{[a]} |
| I-307 | H | (1E)-1- | H | O | 3-(trifluoromethyl)phenyl | 2-(4-chlorophenyl)-2,2-difluoroethyl | 4.77^{[a]} |
| | | (methoxylmino) | | | | | |
| | | ethyl | | | | | |
| I-308 | H | Cl | 3-hydroxyazetidin- | O | 3-(trifluoromethyl)phenyl | 2-(2,4-dimethylphenyl)-2,2-difluoroethyl | 3.50^{[a]} |
| | | | 1-yl | | | | |
| I-309 | H | Cl | H | O | 3-(trifluoromethyl)phenyl | 2-[4-(difluoromethyl)phenyl]ethyl | 3.78^{[a]} |
| I-310 | H | methyl | H | O | 3-(trifluoromethyl)phenyl | rac-1-(3-methoxyphenyl)ethyl | 3.25^{[a]} |
| I-311 | H | methyl | methyl | O | 3-cyclopropyl-2- | 2-(2,4-dichlorophenyl)ethyl | 3.96^{[a]} |
| | | | | | fluorophenyl | | |
| I-312 | H | cyclopropyl | H | O | 3-(trifluoromethyl)phenyl | 2-(4-bromo-2-chlorophenyl)-2,2- | 4.79^{[a]}; |
| | | | | | | difluoroethyl | 4.68^{[b]} |
| I-313 | H | methyl | H | O | 3-nitrophenyl | 2-(2,4-dimethylphenyl)-2,2-difluoroethyl | 3.46^{[a]} |
| I-314 | H | Cl | H | O | 3-(trifluoromethyl)phenyl | 2,2-difluoro-2-[2-methyl-4-[2- | 4.90^{[a]} |
| | | | | | | (trifluoromethyl)cyclopropyl]phenyl]ethyl | |
| I-315 | H | Cl | H | O | 2-fluoro-3- | 2-(4-bromo-2-chlorophenyl)-2,2- | 4.71^{[a]} |
| | | | | | (trifluoromethyl)phenyl | difluoroethyl | |
| I-316 | H | pyridin-4-yl | H | O | 3-(trifluoromethyl)phenyl | 2-(2,4-dimethylphenyl)-2,2-difluoroethyl | 3.65^{[a]} |
| I-317 | H | methyl | methoxy | O | 3-(trifluoromethyl)phenyl | 2-(2,4-dimethylphenyl)-2,2-difluoroethyl | 3.99^{[a]} |
| I-318 | H | Cl | H | O | 3-(trifluoromethyl)phenyl | rac-6-methoxy-1,2,3,4-tetrahydro- | 4.13^{[a]} |
| | | | | | | naphthalen-1-yl | |
| I-319 | H | 3-chloropyridin- | H | O | 3-(difluoromethyl)-2- | rac-2-(4-bromo-2-chlorophenyl)-2- | 4.25^{[a]} |
| | | 4-yl | | | fluorophenyl | fluoroethyl | |
| I-320 | H | Cl | H | O | 3-(trifluoromethyl)phenyl | rac-1-[4-(trifluoromethyl)phenyl]ethyl | 4.23^{[a]} |
| I-321 | H | Cl | H | O | 3-(trifluoromethyl)phenyl | 2,2-difluoro-2-phenylethyl | 3.73^{[a]} |
| I-322 | H | Cl | H | O | 3-(trifluoromethyl)phenyl | 2-(2,4-dichlorophenyl)-2,2-difluoroethyl | 4.40^{[a]} |
| I-323 | H | Cl | H | O | 3-(trifluoromethyl)phenyl | 2-(4-chlorophenyl)propyl | 4.28^{[a]} |
| I-324 | H | 3-chloropyridin- | H | O | 3-(trifluoromethyl)phenyl | 2-(2,4-dimethylphenyl)-2,2-difluoroethyl | 4.37^{[a]} |
| | | 4-yl | | | | | |
| I-325 | H | Cl | H | O | 3-(trifluoromethyl)phenyl | [rac-6-chloro-2,3-dihydro-1-benzofuran-3- | 3.99^{[a]}; |
| | | | | | | yl]methyl | 3.90^{[b]} |
| I-326 | H | H | I | O | 3-(trifluoromethyl)phenyl | 2-(2,4-dichlorophenyl)-2,2-difluoroethyl | 4.24^{[a]} |
| I-327 | H | Cl | H | O | 3-iodophenyl | 2-(2,4-dimethylphenyl)-2,2-difluoroethyl | 4.61^{[a]} |
| I-328 | H | Cl | H | O | 3-(trifluoromethyl)phenyl | 2-(4-chloro-2-methylphenyl)-2,2- | 4.51^{[a]} |
| | | | | | | difluoroethyl | |
| I-329 | H | Cl | H | O | 3-(trifluoromethyl)phenyl | 1-[(4-chlorophenyl)methyl]cyclopropyl | 4.17^{[a]} |
| I-330 | H | Cl | 2-methoxyethyl | O | 3-(trifluoromethyl)phenyl | rac-1-(4-methylphenyl)ethyl | 4.23^{[a]} |
| I-331 | H | Cl | H | O | 3-(trifluoromethyl)phenyl | rac-5-bromoindan-1-yl | 4.52^{[a]}; |
| | | | | | | | 4.42^{[b]} |
| I-332 | H | Cl | H | O | 3-(trifluoromethyl)phenyl | rac-1-(1-methyl-1H-indol-3-yl)ethyl | 4.03^{[a]} |
| I-333 | H | H | cyclopropyl | O | 3-(trifluoromethyl)phenyl | 2-(2,4-dichlorophenyl)-2,2-difluoroethyl | 4.18^{[a]} |
| I-334 | H | Cl | H | O | 3-(trifluoromethyl)phenyl | 2-(4-bromo-2-cyanophenyl)-2,2- | 3.89^{[a]} |
| | | | | | | difluoroethyl | |
| I-335 | methoxy- | Cl | H | O | 3-(trifluoromethyl)phenyl | 2-(2,4-dimethylphenyl)-2,2-difluoroethyl | 5.19^{[a]} |
| | carbonyl | | | | | | |
| I-336 | H | methyl | methyl | O | 3-(trifluoromethyl)phenyl | 2-(2,4-dichlorophenyl)-2,2-difluoroethyl | 3.94^{[a]} |
| I-337 | H | Cl | H | O | 2-fluoro-3-methoxyphenyl | 2-(2,4-dimethylphenyl)-2,2-difluoroethyl | 4.01^{[a]} |
| I-338 | H | Cl | methyl | O | 3-(trifluoromethyl)phenyl | 2-(2,4-dichlorophenyl)-2,2-difluoroethyl | 4.43^{[a]} |
| I-339 | H | Cl | oxetan-3-ylamino | O | 3-(trifluoromethyl)phenyl | 2-(4-chlorophenyl)-2,2-difluoroethyl | 3.47^{[a]}; |
| | | | | | | | 3.32^{[b]} |
| I-340 | H | Cl | H | O | 3-(trifluoromethyl)phenyl | rac-1-(6-methoxynaphthalen-2-yl)ethyl | 4.27^{[a]} |
| I-341 | H | Cl | H | O | 3-(trifluoromethyl)phenyl | 2-[4-methyl-2-(1-methyl-1H-imidazol-2- | 1.85^{[a]} |
| | | | | | | yl)phenyl]ethyl | |
| I-342 | H | methyl | methyl | O | 3-cyclopropyl-2- | rac-2-(2,4-dichlorophenyl)-2-fluoroethyl | 3.90^{[a]} |
| | | | | | fluorophenyl | | |
| I-343 | H | methyl | H | O | 3-cyclopropyl-2- | 2-(2,4-dichlorophenyl)ethyl | 4.32^{[a]} |
| | | | | | fluorophenyl | | |
| I-344 | H | methyl | H | O | 3-(trifluoromethyl)phenyl | 2-(4-bromo-2-methylphenyl)-2,2- | 4.17^{[a]} |
| | | | | | | difluoroethyl | |
| I-345 | H | Cl | OH | O | 3-(trifluoromethyl)phenyl | 2-(2,4-dimethylphenyl)-2,2-difluoroethyl | 4.28^{[a]} |
| I-346 | H | Cl | H | O | 3-(trifluoromethyl)phenyl | rac-1-(3-bromophenyl)ethyl | 4.23^{[a]} |
| I-347 | H | methyl | H | O | 3-(trifluoromethyl)phenyl | 2-(2,4-dimethylphenyl)ethyl | 3.99^{[a]} |
| I-348 | H | methyl | H | O | 3-(trifluoromethyl)phenyl | 2-(4-chloro-2-methylphenyl)-2,2- | 4.05^{[a]} |
| | | | | | | difluoroethyl | |
| I-349 | H | Cl | OH | O | 3-(trifluoromethyl)phenyl | 2-(4-bromo-2-chlorophenyl)-2,2- | 4.51^{[a]} |
| | | | | | | difluoroethyl | |
| I-350 | H | rac-1-hydroxy- | H | O | 3-(trifluoromethyl)phenyl | rac-2-(4-bromo-2-chloro-phenyl)-2- | 3.69^{[a]} |
| | | ethyl | | | | fluoroethyl | |
| I-351 | H | 3-chloropyridin- | methyl | O | 3-(trifluoromethyl)phenyl | 2-(2,4-dichlorophenyl)-2,2-difluoroethyl | 4.39^{[a]}; |
| | | 4-yl | | | | | 4.51^{[b]} |
| I-352 | H | Cl | H | O | 3-(trifluoromethyl)phenyl | rac-1-(5,6,7,8-tetrahydronaphthalen-2- | 4.85^{[a]} |
| | | | | | | yl)ethyl | |
| I-353 | H | Cl | [formyl(methyl) | O | 3-(trifluoromethyl)phenyl | 2-(2,4-dimethylphenyl)ethyl | 3.59^{[a]} |
| | | | amino]methyl | | | | |
| I-354 | H | methyl | H | O | 3-(trifluoromethyl)phenyl | 2-(4-bromo-2-cyanophenyl)-2,2- | 3.47^{[a]} |
| | | | | | | difluoroethyl | |
| I-355 | H | Cl | H | O | 3-(trifluoromethyl)phenyl | [1-[3- | 4.53^{[a]} |
| | | | | | | (trifluoromethyl)phenyl]cyclopropyl] | |
| | | | | | | methyl | |
| (*) I-356 | H | Cl | H | O | 3-(trifluoromethyl)phenyl | rac-6-methyl-1,2,3,4-tetrahydro- | 4.51^{[a]} |
| | | | | | | naphthalen-1-yl | |
| I-357 | H | Cl | H | O | 3-(trifluoromethyl)phenyl | 2-(4-chlorophenyl)propan-2-yl | 4.44^{[a]} |
| I-358 | H | methyl | H | O | 3-(difluoromethyl)-2- | rac-2-(4-bromo-2-chlorophenyl)-2- | 3.83^{[a]} |
| | | | | | fluorophenyl | fluoroethyl | |
| (*) I-359 | H | Cl | H | O | 3-(trifluoromethyl)phenyl | rac-2-(4-bromo-2-chlorophenyl)-2- | 4.56^{[a]}; |
| | | | | | | fluoroethyl | 4.46^{[b]} |
| I-360 | H | Cl | H | O | 3-(trifluoromethyl)phenyl | 2-(2-chloro-4-cyclopropylphenyl)-2,2- | 4.58^{[a]} |
| | | | | | | difluoroethyl | |
| I-361 | H | Cl | isopropyl | O | 3-(trifluoromethyl)phenyl | 2-(2,4-dimethylphenyl)-2,2-difluoroethyl | 4.93^{[a]} |
| I-362 | H | Cl | H | O | 3-cyclopropylphenyl | rac-2-(4-bromo-2-chlorophenyl)-2- | 4.87^{[a]} |
| | | | | | | fluoroethyl | |
| I-363 | H | rac-1- | H | O | 3-(trifluoromethyl)phenyl | 2-(4-chlorophenyl)-2,2-difluoroethyl | 3.35^{[a]} |
| | | hydroxyethyl | | | | | |
| I-364 | H | Cl | H | O | 3-(trifluoromethyl)phenyl | rac-1-(3-fluoro-4-methoxyphenyl)ethyl | 3.69^{[a]} |
| I-365 | H | methyl | H | S | 3-(difluoromethyl)phenyl | 2-(2,4-dimethylphenyl)-2,2-difluoroethyl | 4.23^{[a]} |
| I-366 | H | Cl | H | O | 3-(trifluoromethyl)phenyl | 2-(4-chloro-2-methylphenyl)-2-fluoroethyl | 4.37^{[a]} |
| (*) I-367 | H | Cl | H | O | 3-cyclopropylphenyl | rac-2-(2,4-dichlorophenyl)-2-fluoroethyl | 4.68^{[a]} |
| I-368 | H | Cl | H | O | 3-(trifluoromethyl)phenyl | 2-(4-cyanophenyl)propan-2-yl | 3.67^{[a]} |
| I-369 | H | methyl | methyl | O | 3-(difluoromethyl)-2- | rac-2-(4-bromo-2-chlorophenyl)-2- | 3.65^{[a]} |
| | | | | | fluorophenyl | fluoroethyl | |
| I-370 | H | methyl | H | S | 3-cyclopropylphenyl | 2-(2,4-dimethylphenyl)-2,2-difluoroethyl | 4.72^{[a]} |
| I-371 | H | methyl | H | O | 3-(trifluoromethyl)phenyl | 2-(4-bromo-2-chlorophenyl)-2,2- | 4.24^{[a]} |
| | | | | | | difluoroethyl | |
| I-372 | H | Cl | H | O | 3-(trifluoromethyl)phenyl | 2-(4-bromo-2-methylphenyl)-2-fluoroethyl | 4.46^{[a]} |
| I-373 | H | Cl | H | O | 3-(trifluoromethyl)phenyl | rac-1-(3,4-dimethylphenyl)ethyl | 4.39^{[a]} |
| I-374 | H | methyl | H | O | 3-(difluoromethyl)-2- | rac-2-(2,4-dichlorophenyl)-2-fluoroethyl | 3.74^{[a]} |
| | | | | | fluorophenyl | | |
| I-375 | H | methyl | H | O | 3-(trifluoromethyl)phenyl | 2-(4-chlorophenyl)-2,2-difluoroethyl | 3.68^{[a]} |
| I-376 | H | Cl | H | O | 3-(trifluoromethyl)phenyl | [1-(4-bromo-2- | 5.14^{[a]} |
| | | | | | | chlorophenyl)cyclopropyl]methyl | |
| I-377 | H | Cl | H | O | 3-(trifluoromethyl)phenyl | 2-fluoro-2-(4-fluorophenyl)ethyl | 3.63^{[a]} |
| (*) I-378 | H | Cl | H | O | 3-(trifluoromethyl)phenyl | rac-2-chloro-4,5,6,7-tetrahydro-1- | 4.66^{[a]} |
| | | | | | | benzothiophen-7-yl | |
| I-379 | H | Cl | H | O | 3-(trifluoromethyl)phenyl | isoquinolin-4-ylmethyl | 2.14^{[a]} |
| (*) I-380 | H | methyl | H | O | 3-(trifluoromethyl)phenyl | 2-chloro-4,5,6,7-tetrahydro-1-benzo- | 4.18^{[a]} |
| | | | | | | thiophen-7-yl | |
| I-381 | H | pyridin-4-yl | cyclopropylamino | O | 3-(trifluoromethyl)phenyl | 2-(4-chlorophenyl)-2,2-difluoroethyl | 3.07^{[a]} |
| I-382 | H | Cl | H | O | 3-methoxyphenyl | rac-2-(2,4-dichlorophenyl)-2-fluoroethyl | 3.97^{[a]} |
| I-383 | H | Cl | 2-oxopyrrolidin- | O | 3-(trifluoromethyl)phenyl | 2-(2,4-dimethylphenyl)-2,2-difluoroethyl | 4.16^{[a]} |
| | | | 1-yl | | | | |
| I-384 | H | Cl | H | O | 3-(trifluoromethyl)phenyl | 2-(4-methoxyphenyl)propan-2-yl | 4.03^{[a]} |
| I-385 | H | methyl | H | O | 3-(difluoromethyl)-2- | 2-(2,4-dimethylphenyl)-2,2-difluoroethyl | 3.72^{[a]} |
| | | | | | fluorophenyl | | |
| I-386 | H | Cl | methyl | O | 3-(trifluoromethyl)phenyl | rac-1-(1-methyl-1H-indol-3-yl)ethyl | 3.90^{[a]} |
| I-387 | H | Cl | H | O | 3-(trifluoromethyl)phenyl | 2,2-difluoro-2-[2-methyl-4- | 4.51^{[a]} |
| | | | | | | (trifluoromethyl)phenyl]ethyl | |
| I-388 | H | Cl | H | O | 3-(trifluoromethyl)phenyl | 2-fluoro-2-(4-iodophenyl)ethyl | 4.23^{[a]} |
| I-389 | H | Cl | 2-methoxyethyl | O | 3-(trifluoromethyl)phenyl | 2-(2,4-dimethylphenyl)-2,2-difluoroethyl | 4.67^{[a]} |
| I-390 | H | Cl | H | O | 3-(trifluoromethyl)phenyl | quinolin-5-ylmethyl | 2.25^{[a]} |
| I-391 | H | H | methyl | O | 3-(trifluoromethyl)phenyl | 2-(2,4-dimethylphenyl)-2,2-difluoroethyl | 3.67^{[a]} |
| (*) I-392 | H | methyl | H | O | 3-(trifluoromethyl)phenyl | 2-chloro-4,5,6,7-tetrahydro-1- | 4.18^{[a]} |
| | | | | | | benzothiophen-7-yl | |
| I-393 | H | methyl | H | O | 3-(trifluoromethyl)phenyl | rac-6-methyl-1,2,3,4-tetrahydro- | 4.05^{[a]} |
| | | | | | | naphthalen-1-yl | |
| I-394 | H | Cl | H | O | 3-(trifluoromethyl)phenyl | rac-1-(1,3-benzodioxol-5-yl)ethyl | 3.64^{[a]} |
| I-395 | H | methyl | H | O | 3-(difluoromethyl)-2- | 2-(5-chloropyridin-2-yl)-2,2- | 3.02^{[a]} |
| | | | | | fluorophenyl | difluoroethyl | |
| I-396 | H | methyl | H | O | 3-(trifluoromethyl)phenyl | 2,2-difluoro-2-phenylethyl | 3.28^{[a]} |
| I-397 | H | Cl | H | O | 3-(trifluoromethyl)phenyl | [1-(2,4-dimethylphenyl)cyclopropyl]methyl | 4.90^{[a]} |
| I-398 | H | Cl | 2-methoxyethyl | O | 3-(trifluoromethyl)phenyl | 2-(4-chlorophenyl)-2,2-difluoroethyl | 4.37^{[a]} |
| I-399 | H | Cl | H | O | 3-fluorophenyl | rac-2-(4-bromo-2-chlorophenyl)-2- | 4.16^{[a]} |
| | | | | | | fluoroethyl | |
| I-400 | H | methyl | cyclopropylamino | O | 3-(trifluoromethyl)phenyl | 2-(2,4-dimethylphenyl)-2,2-difluoroethyl | 3.42^{[a]} |
| I-401 | H | H | H | O | 3-(trifluoromethyl)phenyl | 2-(2,4-dichlorophenyl)-2,2-difluoroethyl | 3.99^{[a]} |
| I-402 | H | Cl | H | O | 3-(trifluoromethyl)phenyl | rac-1-(2,3-dihydro-1-benzofuran-5-yl)ethyl | 3.71^{[a]} |
| I-403 | H | methyl | methyl | O | 3-(difluoromethyl)-2- | 2-(2,4-dichlorophenyl)-2,2-difluoroethyl | 3.63^{[a]} |
| | | | | | fluorophenyl | | |
| I-404 | H | Cl | H | O | 3-(trifluoromethyl)phenyl | 2-(4-bromo-2-methylphenyl)-2,2- | 4.57^{[a]} |
| | | | | | | difluoroethyl | |
| I-405 | H | Cl | H | O | 3-(difluoromethyl)phenyl | 2-(2,4-dimethylphenyl)-2,2-difluoroethyl | 4.16^{[a]} |
| I-406 | H | Cl | H | O | 3-(trifluoromethyl)phenyl | 2-fluoro-2-[4-(trifluoromethyl)phenyl]ethyl | 4.08^{[a]} |
| (*) I-407 | H | Cl | H | O | 2,3-difluorophenyl | rac-2-(4-bromo-2-chlorophenyl)-2- | 4.26^{[a]} |
| | | | | | | fluoroethyl | |
| I-408 | H | Cl | oxetan-3-ylamino | O | 3-(trifluoromethyl)phenyl | 2-(2,4-dimethylphenyl)-2,2-difluoroethyl | 3.85^{[a]}; |
| | | | | | | | 3.94^{[b]} |
| I-409 | H | methyl | methyl | O | 3-(difluoromethyl)-2- | 2-(2,4-dichlorophenyl)ethyl | 3.52^{[a]} |
| | | | | | fluorophenyl | | |
| I-410 | H | methyl | methyl | O | 3-cyclopropyl-2- | 2-(2,4-dimethylphenyl)-2,2-difluoroethyl | 3.92^{[a]} |
| | | | | | fluorophenyl | | |
| I-411 | H | methyl | H | O | 3-(trifluoromethyl)phenyl | 2-(2,4-dimethylphenyl)-2,2-difluoroethyl | 4.00^{[a]} |
| I-412 | H | Cl | H | O | 3-(trifluoromethyl)phenyl | [1-(3-methylphenyl)cyclopropyl]methyl | 4.59^{[a]} |
| I-413 | H | Cl | H | O | 3-chloro-4-fluorophenyl | 2-(2,4-dimethylphenyl)-2,2-difluoroethyl | 4.44^{[a]} |
| I-414 | H | Cl | H | O | 3-(trifluoromethyl)phenyl | rac-1-(3,4-difluorophenyl)ethyl | 3.92^{[a]} |
| I-415 | H | methyl | methyl | O | 3-(difluoromethyl)-2- | rac-2-(2,4-dichlorophenyl)-2-fluoroethyl | 3.50^{[a]} |
| | | | | | fluorophenyl | | |
| I-416 | H | methyl | H | O | 3-(trifluoromethyl)phenyl | 2-(5-bromo-3-chloropyridin-2-yl)-2,2- | 3.85^{[a]} |
| | | | | | | difluoroethyl | |
| I-417 | H | Cl | H | O | 3-nitrophenyl | 2-(2,4-dimethylphenyl)-2,2-difluoroethyl | 4.01^{[a]} |
| I-418 | H | Cl | H | O | 3-(trifluoromethyl)phenyl | 2-[2-chloro-4-(trifluoromethyl)phenyl]- | 4.45^{[a]} |
| | | | | | | 2,2-difluoroethyl | |
| I-419 | H | Cl | I | O | 3-(trifluoromethyl)phenyl | 2-(2,4-dimethylphenyl)ethyl | 4.49^{[a]} |
| I-420 | H | Cl | H | O | 3-(trifluoromethyl)phenyl | rac-6-bromo-1,2,3,4-tetrahydronaphthalen- | 4.72^{[a]}; |
| | | | | | | 1-yl | 4.64^{[b]} |
| I-421 | H | Cl | H | O | 3-bromo-4-fluorophenyl | rac-2-(4-bromo-2-chlorophenyl)-2- | 4.56^{[a]} |
| | | | | | | fluoroethyl | |
| I-422 | H | Cl | 2-methoxyethoxy | O | 3-(trifluoromethyl)phenyl | 2-(4-chlorophenyl)-2,2-difluoroethyl | 4.23^{[a]} |
| (*) I-423 | H | methyl | methyl | O | 3-(trifluoromethyl)phenyl | rac-2-(2,4-dichlorophenyl)-2-fluoroethyl | 3.79^{[a]} |
| I-424 | H | methyl | methyl | O | 3-(difluoromethyl)-2- | 2-(2,4-dimethylphenyl)-2,2-difluoroethyl | 3.59^{[a]} |
| | | | | | fluorophenyl | | |
| I-425 | H | Cl | H | O | 3-(trifluoromethyl)phenyl | 2,2-difluoro-2-[4- | 4.17^{[a]} |
| | | | | | | (trifluoromethyl)phenyl]ethyl | |
| I-426 | H | Cl | H | O | 3-(trifluoromethyl)phenyl | 2-[2-chloro-4-(trifluoromethyl)phenoxy] | 4.34^{[a]} |
| | | | | | | ethyl | |
| I-427 | H | Cl | H | O | 3-chloro-4-methylphenyl | 2-(2,4-dimethylphenyl)-2,2-difluoroethyl | 4.76^{[a]} |
| I-428 | H | methyl | methyl | O | 3-(trifluoromethyl)phenyl | 2-(4-bromo-2-chlorophenyl)-2,2- | 4.04^{[a]} |
| | | | | | | difluoroethyl | |
| I-429 | H | Cl | H | O | 3-bromo-5-fluorophenyl | rac-2-(4-bromo-2-chlorophenyl)-2- | 4.70^{[a]} |
| | | | | | | fluoroethyl | |
| I-430 | H | Cl | pyridin-2-yl | O | 3-(trifluoromethyl)phenyl | 2-(2,4-dimethylphenyl)-2,2-difluoroethyl | 4.26^{[a]} |
| I-431 | H | 1-hydroxylmino- | H | O | 3-(trifluoromethyl)phenyl | 2-(4-bromo-2-chlorophenyl)-2,2- | 4.24^{[a]} |
| | | ethyl | | | | difluoroethyl | |
| I-432 | H | H | 1H-pyrazol-1-yl | O | 3-(trifluoromethyl)phenyl | 2-(2,4-dimethylphenyl)-2,2-difluoroethyl | 4.01^{[a]}; |
| | | | | | | | 4.12^{[b]} |
| I-433 | H | Cl | H | O | 3-(trifluoromethyl)phenyl | 2-(4-methylphenyl)propan-2-yl | 4.41^{[a]} |
| I-434 | H | Cl | azetidin-3-yloxy | O | 3-(trifluoromethyl)phenyl | 2-(2,4-dimethylphenyl)-2,2-difluoroethyl | 2.40^{[a]} |
| I-435 | H | methyl | H | O | 3-(trifluoromethyl)phenyl | 2,2-difluoro-2-[2-methyl-4- | 4.17^{[a]} |
| | | | | | | (trifluoromethyl)phenyl]ethyl | |
| I-436 | H | Cl | H | O | 3-(trifluoromethyl)phenyl | [rac-indolin-3-yl]methyl | 2.42^{[a]} |
| I-437 | H | Cl | H | O | 4-(trifluoromethyl)phenyl | 2-(2,4-dimethylphenyl)-2,2-difluoroethyl | 4.51^{[a]} |
| (*) I-438 | H | Cl | H | O | 3-(trifluoromethyl)phenyl | spiro[cyclopropane-2,1′-indane]-1-yl | 4.27^{[a]} |
| I-439 | H | Cl | H | O | 3-(trifluoromethyl)phenyl | [rac-5-bromoindan-1-yl]methyl | 4.61^{[a]}; |
| | | | | | | | 4.56^{[b]} |
| I-440 | H | H | 1,3-thiazol-4-yl | O | 3-(trifluoromethyl)phenyl | 2-(2,4-dimethylphenyl)-2,2-difluoroethyl | 4.05^{[a]}; |
| | | | | | | | 4.08^{[b]} |
| I-441 | H | Cl | H | O | 3-(difluoromethyl)-2- | 2-(4-bromophenyl)-2,2-difluoroethyl | 3.96^{[a]} |
| | | | | | fluorophenyl | | |
| I-442 | H | Cl | ethylsulfanyl | O | 3-(trifluoromethyl)phenyl | 2-(2,4-dimethylphenyl)-2,2-difluoroethyl | 4.87^{[a]} |
| I-443 | H | Cl | methyl | O | 3-(trifluoromethyl)phenyl | 2-(4-bromo-2-chlorophenyl)ethyl | 4.51^{[a]} |
| I-444 | H | Cl | H | O | 3-(trifluoromethyl)phenyl | rac-1-(4-bromophenyl)ethyl | 4.30^{[a]} |
| I-445 | H | ethyl | methyl | O | 3-(trifluoromethyl)phenyl | rac-2-(2,4-dichlorophenyl)-2-fluoroethyl | 4.25^{[a]} |
| I-446 | H | Cl | H | O | 3-(difluoromethyl)-2- | 2-(2,4-dimethylphenyl)-2,2-difluoroethyl | 4.15^{[a]} |
| | | | | | fluorophenyl | | |
| I-447 | H | Cl | H | O | 3-bromophenyl | 2-(2,4-dimethylphenyl)-2,2-difluoroethyl | 4.59^{[a]} |
| (*) I-448 | H | Cl | H | O | 3-(trifluoromethyl)phenyl | spiro[cyclopropane-2,1′-indane]-1-yl | 4.37^{[a]} |
| I-449 | H | Cl | H | O | 5-bromopyridin-3-yl | 2-(4-chlorophenyl)-2,2-difluoroethyl | 3.46^{[a]}; |
| | | | | | | | 3.37^{[b]} |
| I-450 | H | 1-hydroxylmino- | H | O | 3-(trifluoromethyl)phenyl | rac-2-(4-bromo-2-chlorophenyl)-2- | 4.32^{[a]} |
| | | ethyl | | | | fluoroethyl | |
| I-451 | H | (1Z)-1- | H | O | 3-(trifluoromethyl)phenyl | 2-(4-chlorophenyl)-2,2-difluoroethyl | 4.40^{[a]} |
| | | (methoxylmino) | | | | | |
| | | ethyl | | | | | |
| I-452 | H | (1Z)-1- | H | O | 3-(trifluoromethyl)phenyl | rac-2-(4-bromo-2-chlorophenyl)-2- | 4.77^{[a]} |
| | | (methoxylmino) | | | | fluoroethyl | |
| | | ethyl | | | | | |
| I-453 | H | Cl | methyl | O | 3-(trifluoromethyl)phenyl | 2-(4-chlorophenyl)ethyl | 3.92^{[a]} |
| I-454 | H | Cl | H | O | 3-(trifluoromethyl)phenyl | rac-1-(6-methylnaphthalen-2-yl)ethyl | 4.74^{[a]} |
| I-455 | H | ethyl | methyl | O | 3-(trifluoromethyl)phenyl | rac-2-(4-bromo-2-chlorophenyl)-2- | 4.30^{[a]} |
| | | | | | | fluoroethyl | |
| I-456 | H | Cl | H | O | 3-(difluoromethyl)-2- | 2-(5-chloropyridin-2-yl)-2,2-difluoroethyl | 3.44^{[a]} |
| | | | | | fluorophenyl | | |
| I-457 | H | Cl | methylamino | O | 3-cyclopropyl-2- | 2-(2,4-dimethylphenyl)-2,2-difluoroethyl | 4.01^{[a]} |
| | | | | | fluorophenyl | | |
| I-458 | H | Cl | H | O | 3-(trifluoromethyl)phenyl | 2-(2,4-dichlorophenyl)-2-fluoroethyl | 4.46^{[a]} |
| I-459 | H | Cl | H | O | 3-chlorophenyl | 2-(2,4-dimethylphenyl)-2,2-difluoroethyl | 4.44^{[a]} |
| I-460 | H | Cl | methyl | O | 3-(trifluoromethyl)phenyl | rac-1-(4-methylphenyl)ethyl | 3.99^{[a]} |
| I-461 | H | I | H | O | 3-(trifluoromethyl)phenyl | 2-(2,4-dimethylphenyl)-2,2-difluoroethyl | 4.67^{[a]} |
| I-462 | H | Cl | H | O | 3-fluorophenyl | 2-(4-chlorophenyl)-2,2-difluoroethyl | 3.77^{[a]} |
| I-463 | H | Cl | H | O | 5-bromopyridin-3-yl | 2-(2,4-dichlorophenyl)-2,2-difluoroethyl | 3.82^{[a]}; |
| | | | | | | | 3.75^{[b]} |
| I-464 | H | Cl | methyl | O | 3-(trifluoromethyl)phenyl | 2-(2,4-dichlorophenyl)ethyl | 4.37^{[a]} |
| I-465 | H | 3-methoxypyridin- | H | O | 3-(trifluoromethyl)phenyl | 2-(4-bromo-2-chlorophenyl)-2,2- | 3.94^{[a]} |
| | | 4-yl | | | | difluoroethyl | |
| I-466 | H | Cl | H | O | 3-(trifluoromethyl)phenyl | rac-1-(3,4-dichlorophenyl)ethyl | 4.51^{[a]} |
| I-467 | H | Cl | H | O | 3-(difluoromethyl)-2- | 2-(4-chlorophenyl)-2,2-difluoroethyl | 3.90^{[a]} |
| | | | | | fluorophenyl | | |
| I-468 | H | Cl | H | O | 3-cyclopropylphenyl | 2-(2,4-dimethylphenyl)-2,2-difluoroethyl | 4.67^{[a]} |
| I-469 | H | Cl | methoxy | O | 3-(trifluoromethyl)phenyl | 2-(4-bromo-2-chlorophenyl)-2,2- | 4.61^{[a]} |
| | | | | | | difluoroethyl | |
| I-470 | H | Cl | H | O | 2,3-difluorophenyl | 2-(4-chlorophenyl)-2,2-difluoroethyl | 3.83^{[a]} |
| I-471 | H | Cl | H | O | 5-bromopyridin-3-yl | 2-(4-bromo-2-chlorophenyl)-2,2- | 3.92^{[a]}; |
| | | | | | | difluoroethyl | 4.84^{[b]} |
| I-472 | H | Cl | H | O | 3-(trifluoromethyl)phenyl | 2-(2-chloro-4-prop-1-en-2-ylphenyl)-2,2- | 4.80^{[a]}; |
| | | | | | | difluoroethyl | 4.76^{[b]} |
| I-473 | H | (1E)-1- | H | O | 3-(trifluoromethyl)phenyl | rac-2-(4-bromo-2-chlorophenyl)-2- | 5.30^{[a]} |
| | | (methoxylmino) | | | | fluoroethyl | |
| | | ethyl | | | | | |
| I-474 | H | Cl | 2-methoxyethyl | O | 3-(trifluoromethyl)phenyl | rac-2-(4-chlorophenyl)-2-fluoroethyl | 4.15^{[a]} |
| I-475 | H | 3-methoxypyridin- | H | O | 3-(trifluoromethyl)phenyl | 2-(2,4-dichlorophenyl)-2,2-difluoroethyl | 3.87^{[a]} |
| | | 4-yl | | | | | |
| I-476 | H | Cl | H | O | 3-(trifluoromethyl)phenyl | 2-(4-fluorophenyl)propan-2-yl | 4.11^{[a]} |
| I-477 | H | methyl | H | O | 3-(difluoromethyl)-2- | 2-(4-bromophenyl)-2,2-difluoroethyl | 3.55^{[a]} |
| | | | | | fluorophenyl | | |
| I-478 | H | Cl | H | O | 3-(trifluoromethyl)phenyl | 2-(2-bromo-4-chlorophenyl)-2,2- | 4.68^{[a]} |
| | | | | | | difluoroethyl | |
| I-479 | H | Cl | H | O | 3-(trifluoromethyl)phenyl | 2-(6-chloropyridin-3-yl)-2,2-difluoroethyl | 3.42^{[a]} |
| I-480 | H | Cl | H | O | 3-ethynylphenyl | 2-(2,4-dimethylphenyl)-2,2-difluoroethyl | 4.15^{[a]} |
| I-481 | H | methyl | H | O | 3-(difluoromethyl)phenyl | rac-2-chloro-4,5,6,7-tetrahydro-1- | 3.74^{[a]} |
| | | | | | | benzothiophen-7-yl | |
| I-482 | H | Cl | H | O | 3-bromo-5-fluorophenyl | 2-(4-chlorophenyl)-2,2-difluoroethyl | 4.27^{[a]} |
| I-483 | H | Cl | H | O | 5-bromopyridin-3-yl | rac-2-(4-bromo-2-chlorophenyl)-2- | 3.87^{[a]}; |
| | | | | | | fluoroethyl | 3.80^{[b]} |
| I-484 | H | Cl | cyclopropylamino | O | 3-(trifluoromethyl)phenyl | 2-(2,4-dimethoxyphenyl)ethyl | 3.44^{[a]} |
| I-485 | H | Cl | 3-carboxypropyl- | O | 3-(trifluoromethyl)phenyl | 2-(2,4-dimethylphenyl)-2,2-difluoroethyl | 3.50^{[a]} |
| | | | amino | | | | |
| I-486 | H | 3-methoxypyridin- | H | O | 3-(trifluoromethyl)phenyl | 2-(4-bromophenyl)-2,2-difluoroethyl | 3.60^{[a]} |
| | | 4-yl | | | | | |
| I-487 | H | Cl | H | O | 3-(trifluoromethyl)phenyl | rac-1-(3-chlorophenyl)ethyl | 4.13^{[a]} |
| I-488 | H | CN | H | O | 3-(trifluoromethyl)phenyl | 2-(2,4-dimethylphenyl)ethyl | 4.30^{[a]} |
| I-489 | H | Cl | H | O | 3-(trifluoromethyl)phenyl | [rac-chroman-4-yl]methyl | 3.94^{[a]} |
| I-490 | H | Cl | H | O | 3-(trifluoromethoxy)phenyl | 2-(2,4-dimethylphenyl)-2,2-difluoroethyl | 4.63^{[a]} |
| I-491 | H | Cl | H | O | 3-bromo-5-fluorophenyl | 2-(4-bromo-2-chlorophenyl)-2,2- | 4.72^{[a]} |
| | | | | | | difluoroethyl | |
| I-492 | H | Cl | H | O | 3-bromo-4-fluorophenyl | 2-(4-chlorophenyl)-2,2-difluoroethyl | 4.15^{[a]} |
| I-493 | H | Cl | cyclopropylamino | O | 3-(trifluoromethyl)phenyl | rac-2-(4-chlorophenyl)-2-fluoroethyl | 3.76^{[a]} |
| I-494 | H | 3-chloropyridin- | H | O | 2,3-difluorophenyl | rac-2-(4-bromo-2-chlorophenyl)-2- | 4.13^{[a]} |
| | | 4-yl | | | | fluoroethyl | |
| I-495 | H | Cl | H | O | 3-(trifluoromethyl)phenyl | rac-1-(4-fluorophenyl)ethyl | 3.83^{[a]} |
| I-496 | H | Cl | H | O | 3-(trifluoromethyl)phenyl | 2-(2-chloro-4-methylphenyl)-2,2- | 4.28^{[a]} |
| | | | | | | difluoroethyl | |
| I-497 | H | Cl | methyl | O | 3-(trifluoromethyl)phenyl | 2-(2,4-dimethylphenyl)-2,2-difluoroethyl | 4.46^{[a]} |
| I-498 | H | Cl | H | O | 3-(trifluoromethyl)phenyl | 2,2-difluoro-2-(3-fluorophenyl)ethyl | 3.89^{[a]} |
| I-499 | H | Cl | H | O | 5-(trifluoromethyl)pyridin- | 2-(2,4-dimethylphenyl)-2,2-difluoroethyl | 3.96^{[a]}; |
| | | | | | 3-yl | | 4.11^{[b]} |
| I-500 | H | Cl | methyl | O | 3-(trifluoromethyl)phenyl | 2-(2,4-dimethoxyphenyl)ethyl | 3.65^{[a]} |
| I-501 | H | 3-chloropyridin- | H | O | 2,3-difluorophenyl | rac-2-(2,4-dichlorophenyl)-2-fluoroethyl | 4.03^{[a]} |
| | | 4-yl | | | | | |
| I-502 | H | Cl | H | O | 3-(trifluoromethyl)phenyl | rac-1-(3-methoxyphenyl)ethyl | 3.76^{[a]} |
| I-503 | H | methyl | methyl | O | 3-cyclopropylphenyl | rac-2-(4-bromo-2-chlorophenyl)-2- | 3.92^{[a]} |
| | | | | | | fluoroethyl | |
| I-504 | H | methyl | H | O | 3-cyclopropyl-2- | rac-1-(1-methyl-1H-indol-3-yl)ethyl | 3.72^{[a]} |
| | | | | | fluorophenyl | | |
| I-505 | H | Cl | H | O | 3-(trifluoromethyl)phenyl | 2-(4-bromo-2-fluorophenyl)-2,2- | 4.17^{[a]} |
| | | | | | | difluoroethyl | |
| I-506 | H | Cl | methyl | O | 3-(trifluoromethyl)phenyl | 2-(2,4-dimethylphenyl)ethyl | 4.30^{[a]} |
| I-507 | H | 1-methyl-1H- | H | O | 3-(trifluoromethyl)phenyl | 2-(2,4-dimethylphenyl)-2,2-difluoroethyl | 2.62^{[a]} |
| | | imidazol-5-yl | | | | | |
| I-508 | H | Cl | H | O | 5-chloropyridin-3-yl | 2-(2,4-dimethylphenyl)-2,2-difluoroethyl | 3.72^{[a]}; |
| | | | | | | | 3.87^{[b]} |
| I-509 | H | (1Z)-1- | H | O | 3-(trifluoromethyl)phenyl | 2-(4-bromo-2-chlorophenyl)-2,2- | 4.82^{[a]} |
| | | (methoxylmino) | | | | difluoroethyl | |
| | | ethyl | | | | | |
| I-510 | H | Cl | methyl | O | 3-(trifluoromethyl)phenyl | rac-2-(4-chlorophenyl)-2-fluoroethyl | 3.92^{[a]} |
| I-511 | H | methyl | H | O | 3-(trifluoromethyl)phenyl | 2,2-difluoro-2-(5-methoxypyridin-2-yl)ethyl | 2.96^{[a]}; |
| | | | | | | | 3.11^{[b]} |
| I-512 | H | 3-chloropyridin- | H | O | 2,3-difluorophenyl | 2-(4-bromo-2-chlorophenyl)-2,2- | 4.18^{[a]} |
| | | 4-yl | | | | difluoroethyl | |
| I-513 | H | methyl | H | O | 3-cyclopropyl-2- | rac-1-(1,5-dimethyl-1H-indol-3-yl)ethyl | 4.03^{[a]} |
| | | | | | fluorophenyl | | |
| I-514 | H | Cl | H | O | 3-(trifluoromethyl)phenyl | 2-(4-bromophenyl)-2,2-difluoroethyl | 4.11^{[a]} |
| I-515 | H | 1H-pyrazol-4-yl | H | O | 3-(trifluoromethyl)phenyl | 2-(2,4-dimethylphenyl)-2,2-difluoroethyl | 3.65^{[a]} |
| I-516 | H | Cl | methyl | O | 3-(trifluoromethyl)phenyl | 2-(4-bromo-2-chlorophenyl)-2,2- | 4.64^{[a]} |
| | | | | | | difluoroethyl | |
| I-517 | H | Cl | H | O | 3-(trifluoromethyl)phenyl | [rac-1,2,3,4-tetrahydronaphthalen-1- | 4.61^{[a]} |
| | | | | | | yl]methyl | |
| I-518 | H | Cl | H | O | 5-fluoropyridin-3-yl | 2-(2,4-dimethylphenyl)-2,2-difluoroethyl | 3.37^{[a]}; |
| | | | | | | | 3.55^{[b]} |
| I-519 | H | Cl | H | O | 3-(trifluoromethyl)phenyl | 2-(4-ethynyl-2-methylphenyl)-2,2- | 4.32^{[a]} |
| | | | | | | difluoroethyl | |
| I-520 | H | Cl | H | O | 3-fluorophenyl | 2-(4-bromo-2-chlorophenyl)-2,2- | 4.20^{[a]} |
| | | | | | | difluoroethyl | |
| I-521 | H | Cl | H | O | 3-fluorophenyl | 2-(2,4-dichlorophenyl)-2,2-difluoroethyl | 4.13^{[a]} |
| I-522 | H | Cl | cyclopropylamino | O | 3-(trifluoromethyl)phenyl | 2-(4-bromo-2-chlorophenyl)-2,2- | 4.41^{[a]} |
| | | | | | | difluoroethyl | |
| I-523 | H | (1E)-1- | H | O | 3-(trifluoromethyl)phenyl | 2-(4-bromo-2-chlorophenyl)-2,2- | 5.20^{[a]} |
| | | (methoxylmino) | | | | difluoroethyl | |
| | | ethyl | | | | | |
| I-524 | H | Cl | 2-methoxyethyl | O | 3-(trifluoromethyl)phenyl | 2-(2,4-dimethoxyphenyl)ethyl | 3.85^{[a]} |
| I-525 | H | methyl | H | O | 3-(trifluoromethyl)phenyl | 2-[5-(difluoromethyl)pyridin-2-yl]ethyl | 2.57^{[a]}; |
| | | | | | | | 2.71^{[b]} |
| I-526 | H | 3-chloropyridin- | H | O | 2,3-difluorophenyl | 2-(2,4-dichlorophenyl)-2,2-difluoroethyl | 4.08^{[a]} |
| | | 4-yl | | | | | |
| I-527 | H | Cl | H | O | 3-(trifluoromethyl)phenyl | 3-(4-methylphenyl)oxetan-3-yl | 3.69^{[a]} |
| I-528 | H | methyl | H | O | 3-cyclopropyl-2- | rac-1-(6-chloro-1-methyl-1H-indol-3- | 4.12^{[a]} |
| | | | | | fluorophenyl | yl)ethyl | |
| I-529 | H | Cl | H | O | 3-(trifluoromethyl)phenyl | 2,2-difluoro-2-(2-methylphenyl)ethyl | 4.16^{[a]} |
| I-530 | H | Cl | H | O | 2,3-difluorophenyl | 2-(4-bromo-2-chlorophenyl)-2,2- | 4.27^{[a]} |
| | | | | | | difluoroethyl | |
| I-531 | H | Cl | H | O | 2,3-difluorophenyl | 2-(2,4-dichlorophenyl)-2,2-difluoroethyl | 4.18^{[a]} |
| I-532 | H | 3-chloropyridin- | H | O | 2,3-difluorophenyl | 2-(4-bromophenyl)-2,2-difluoroethyl | 3.83^{[a]} |
| | | 4-yl | | | | | |
| (*) I-533 | H | Cl | methyl | O | 3-methoxyphenyl | rac-2-(2,4-dichlorophenyl)-2-fluoroethyl | 3.85^{[a]} |
| I-534 | H | Cl | methyl | O | 3-(trifluoromethyl)phenyl | 2-(4-chlorophenyl)-2,2-difluoroethyl | 4.18^{[a]} |
| I-535 | H | Cl | H | O | 3-bromo-5-fluorophenyl | 2-(2,4-dichlorophenyl)-2,2-difluoroethyl | 4.64^{[a]} |
| I-536 | H | methyl | H | O | 3-cyclopropylphenyl | rac-2-(2,4-dichlorophenyl)-2-fluoroethyl | 4.05^{[a]} |
| I-537 | H | 3-methylpyridin- | H | O | 3-(trifluoromethyl)phenyl | 2-(4-bromo-2-chlorophenyl)-2,2- | 3.58^{[a]} |
| | | 4-yl | | | | difluoroethyl | |
| I-538 | H | Cl | H | O | 3-(trifluoromethyl)phenyl | 2-(3,4-dichlorophenyl)-2,2-difluoroethyl | 4.51^{[a]} |
| I-539 | H | Cl | H | O | 3-(trifluoromethyl)phenyl | 1-quinolin-2-ylethyl | 4.24^{[a]} |
| I-540 | H | Cl | H | O | 3-bromo-4-fluorophenyl | 2-(2,4-dichlorophenyl)-2,2-difluoroethyl | 4.51^{[a]} |
| I-541 | H | Cl | H | O | 3-(trifluoromethyl)phenyl | 2-(1,3-benzodioxol-5-yl)ethyl | 3.55^{[a]} |
| I-542 | H | Cl | H | O | 3-(trifluoromethyl)phenyl | 2-(4-pyridin-4-ylphenyl)ethyl | 2.13^{[a]} |
| I-543 | H | methyl | H | O | 3-(trifluoromethyl)phenyl | 2-(2-methyl-1,3-benzoxazol-4-yl)ethyl | 2.96^{[a]} |
| I-544 | H | methyl | H | O | 3-cyclopropyl-2- | rac-2-(2,4-dichlorophenyl)-2-fluoroethyl | 4.14^{[a]} |
| | | | | | fluorophenyl | | |
| I-545 | H | 3-methylpyridin- | H | O | 3-(trifluoromethyl)phenyl | rac-2-(4-bromo-2-chlorophenyl)-2- | 3.46^{[a]} |
| | | 4-yl | | | | fluoroethyl | |
| I-546 | H | Cl | 4-methoxy-1H- | O | 3-(trifluoromethyl)phenyl | 2-(2,4-dimethylphenyl)-2,2-difluoroethyl | 4.36^{[a]} |
| | | | pyrazol-1-yl | | | | |
| I-547 | H | Cl | methyl | O | 3-(trifluoromethyl)phenyl | rac-1-(6-chloro-1-methyl-1H-indol-3- | 4.24^{[a]} |
| | | | | | | yl)ethyl | |
| I-548 | H | Cl | H | O | 3-(trifluoromethyl)phenyl | 2-(3-bromo-2-chlorophenyl)-2,2- | 4.59^{[a]} |
| | | | | | | difluoroethyl | |
| I-549 | H | Cl | methyl | O | 3-(trifluoromethyl)phenyl | 2,2-difluoro-2-(3-methylphenyl)ethyl | 4.11^{[a]} |
| I-550 | H | Cl | pyridin-3-yl | O | 3-(trifluoromethyl)phenyl | 2-(2,4-dimethylphenyl)-2,2-difluoroethyl | 3.99^{[a]} |
| I-551 | H | Cl | H | O | 3-(trifluoromethyl)phenyl | 2-(2,3-dihydro-1-benzofuran-5-yl)ethyl | 3.65^{[a]} |
| I-552 | H | rac-1-fluoroethyl | H | O | 3-(trifluoromethyl)phenyl | rac-2-(4-bromo-2-chloro-phenyl)-2- | 4.67^{[a]} |
| | | | | | | fluoroethyl | |
| I-553 | H | 3-methylpyridin- | H | O | 3-(trifluoromethyl)phenyl | rac-2-(2,4-dichlorophenyl)-2-fluoroethyl | 3.37^{[a]} |
| | | 4-yl | | | | | |
| I-554 | H | Cl | cyclopropyloxy | O | 3-(trifluoromethyl)phenyl | 2-(2,4-dimethylphenyl)-2,2-difluoroethyl | 4.72^{[a]} |
| I-555 | H | Cl | methyl | O | 3-cyclopropylphenyl | rac-2-(4-bromo-2-chlorophenyl)-2- | 4.56^{[a]} |
| | | | | | | fluoroethyl | |
| I-556 | H | methyl | methyl | O | 3-cyclopropylphenyl | rac-2-(2,4-dichlorophenyl)-2-fluoroethyl | 3.83^{[a]} |
| I-557 | H | methyl | methyl | O | 3-chlorophenyl | rac-1-(1-methyl-1H-indol-3-yl)ethyl | 3.06^{[a]} |
| I-558 | H | Cl | H | O | 3-(trifluoromethyl)phenyl | isoquinolin-3-ylmethyl | 3.06^{[a]} |
| I-559 | H | Cl | H | O | 3-(trifluoromethyl)phenyl | isoquinolin-5-ylmethyl | 2.14^{[a]} |
| I-560 | H | Cl | H | O | 3-(trifluoromethyl)phenyl | 2-(6-isopropyloxypyridin-3-yl)ethyl | 3.76^{[a]} |
| I-561 | H | methyl | H | O | 3-methoxyphenyl | 2-(4-bromo-2-chlorophenyl)-2,2- | 3.58^{[a]} |
| | | | | | | difluoroethyl | |
| I-562 | H | 3-methylpyridin- | H | O | 3-(trifluoromethyl)phenyl | 2-(2,4-dichlorophenyl)-2,2-difluoroethyl | 3.48^{[a]} |
| | | 4-yl | | | | | |
| I-563 | H | methyl | H | O | 2-fluoro-3- | rac-2-(2,4-dichlorophenyl)-2-fluoroethyl | 4.23^{[a]} |
| | | | | | (trifluoromethyl)phenyl | | |
| I-564 | H | methyl | H | O | 3-cyclobutylphenyl | 2-(2,4-dimethylphenyl)-2,2-difluoroethyl | 3.85^{[a]} |
| I-565 | H | Cl | 4-chloro-1 H- | O | 3-(trifluoromethyl)phenyl | 2-(2,4-dimethylphenyl)-2,2-difluoroethyl | 4.80^{[a]} |
| | | | pyrazol-1-yl | | | | |
| I-566 | H | methyl | methyl | O | 3-cyclopropylphenyl | 2-(2,4-dimethylphenyl)-2,2-difluoroethyl | 3.81^{[a]} |
| I-567 | H | Cl | H | O | 2,2-difluoro-1,3- | 2-(2,4-dichlorophenyl)-2,2-difluoroethyl | 4.56^{[a]} |
| | | | | | benzodioxol-5-yl | | |
| I-568 | H | Cl | H | O | 3-(trifluoromethyl)phenyl | 2-phenoxyethyl | 3.58^{[a]} |
| I-569 | H | Cl | methyl | O | 3-(trifluoromethyl)phenyl | 2-(2,4-difluorophenyl)-2,2-difluoroethyl | 3.90^{[a]} |
| I-570 | H | Cl | H | O | 3-ethylphenyl | 2-(2,4-dimethylphenyl)-2,2-difluoroethyl | 4.68^{[a]} |
| I-571 | H | Cl | H | O | 3-(trifluoromethyl)phenyl | 2-(2,4-dimethoxyphenyl)ethyl | 3.92^{[b]} |
| I-572 | H | cyclopropyl | methyl | O | 3-(trifluoromethyl)phenyl | 2-(2,4-dimethylphenyl)-2,2-difluoroethyl | 4.41^{[a]} |
| I-573 | H | Cl | H | O | 3-(trifluoromethyl)phenyl | 2-(2,3-dihydro-1,4-benzodioxin-6-yl)ethyl | 3.53^{[a]} |
| I-574 | H | methyl | H | O | 3-cyclopropylphenyl | 2-(4-bromo-2-chlorophenyl)-2,2- | 4.28^{[a]} |
| | | | | | | difluoroethyl | |
| I-575 | H | 3-methylpyridin- | H | O | 3-(trifluoromethyl)phenyl | 2-(4-bromophenyl)-2,2-difluoroethyl | 3.23^{[a]} |
| | | 4-yl | | | | | |
| I-576 | H | methyl | H | O | 3-(trifluoromethyl)phenyl | 2-[2-chloro-4-(oxetan-3-yl)phenyl]-2,2- | 3.15^{[a]} |
| | | | | | | difluoroethyl | |
| I-577 | H | ethynyl | H | O | 3-(trifluoromethyl)phenyl | 2-(2,4-dimethylphenyl)-2,2-difluoroethyl | 4.31^{[a]} |
| I-578 | H | Cl | H | O | 3-bromophenyl | 2,2-difluoro-2-(5-methoxypyridin-2-yl)ethyl | 3.33^{[a]}; |
| | | | | | | | 2.99^{[b]} |
| I-579 | H | methyl | H | O | 3-cyclopropyl-2- | 2-(4-bromo-2-chlorophenyl)-2,2- | 4.34^{[a]} |
| | | | | | fluorophenyl | difluoroethyl | |
| I-580 | H | 3-methoxypyridin- | H | O | 3-(trifluoromethyl)phenyl | rac-2-(4-bromo-2-chlorophenyl)-2- | 3.87^{[a]} |
| | | 4-yl | | | | fluoroethyl | |
| I-581 | H | methyl | H | O | 3-cyclopropyl-2- | 2-[5-(difluoromethyl)pyridin-2-yl]ethyl | 2.80^{[a]} |
| | | | | | fluorophenyl | | |
| I-582 | H | methyl | H | O | 3-(trifluoromethyl)phenyl | rac-6-(oxetan-3-yl)-1,2,3,4- | 3.21^{[a]} |
| | | | | | | tetrahydronaphthalen-1-yl | |
| I-583 | H | Cl | H | O | 3-(trifluoromethyl)phenyl | [3-(trifluoromethyl)phenyl]methyl | 3.99^{[a]} |
| I-584 | H | ethynyl | H | O | 3-(trifluoromethyl)phenyl | 2-(4-ethynyl-2-methylphenyl)-2,2- | 4.08^{[a]} |
| | | | | | | difluoroethyl | |
| I-585 | H | Cl | H | O | 3-(trifluoromethyl)phenyl | rac-3-(trifluoromethyl)-5,6,7,8- | 4.04^{[a]}; |
| | | | | | | tetrahydroquinolin-8-yl | 4.14^{[b]} |
| I-586 | H | Cl | H | O | 3-bromophenyl | 2-(2,3-dihydro-1,4-benzodioxin-5-yl)ethyl | 3.72^{[a]} |
| I-587 | H | Cl | H | O | 3-cyclopropylphenyl | 2-(2,4-dichlorophenyl)-2,2-difluoroethyl | 4.65^{[a]} |
| I-588 | H | 3-methoxypyridin- | H | O | 3-(trifluoromethyl)phenyl | rac-2-(2,4-dichlorophenyl)-2-fluoroethyl | 3.76^{[a]} |
| | | 4-yl | | | | | |
| I-589 | H | CHF2 | H | O | 3-(trifluoromethyl)phenyl | rac-2-(2,4-dichlorophenyl)-2-fluoroethyl | 4.49^{[a]} |
| I-590 | H | methyl | methyl | O | 2-fluoro-3- | rac-2-(2,4-dichlorophenyl)-2-fluoroethyl | 3.92^{[a]} |
| | | | | | (trifluoromethyl)phenyl | | |
| I-591 | H | Cl | H | O | 2-fluoro-3-methoxyphenyl | rac-6-bromo-1,2,3,4-tetrahydro- | 4.32^{[a]} |
| | | | | | | naphthalen-1-yl | |
| I-592 | H | methyl | H | O | 3-(trifluoromethyl)phenyl | rac-6-cyclobutyl-1,2,3,4- | 5.08^{[a]} |
| | | | | | | tetrahydronaphthalen-1-yl | |
| I-593 | H | Cl | H | O | 3-(trifluoromethyl)phenyl | rac-4,5,6,7-tetrahydro-1-benzothiophen- | 3.99^{[a]} |
| | | | | | | 7-yl | |
| (*) I-594 | H | Cl | H | O | 3-cyclopropyl-2- | rac-2-(4-bromo-2-chlorophenyl)-2- | 4.80^{[a]} |
| | | | | | fluorophenyl | fluoroethyl | |
| I-595 | H | H | CHF2 | O | 3-(trifluoromethyl)phenyl | rac-2-(2,4-dichlorophenyl)-2-fluoroethyl | 4.24^{[a]} |
| I-596 | H | ethyl | Cl | O | 3-(trifluoromethyl)phenyl | 2-(2,4-dimethylphenyl)ethyl | 4.51^{[a]} |
| I-597 | H | acetyl | H | O | 3-(trifluoromethyl)phenyl | 2-(4-chlorophenyl)-2,2-difluoroethyl | 4.02^{[a]} |
| I-598 | H | Cl | H | O | 3-cyclopropyl-2- | 2-(2,4-dichlorophenyl)-2,2-difluoroethyl | 4.71^{[a]} |
| | | | | | fluorophenyl | | |
| I-599 | H | 3-chloropyridin- | H | O | 3-(trifluoromethyl)phenyl | 2-(4-bromophenyl)-2,2-difluoroethyl | 4.18^{[a]} |
| | | 4-yl | | | | | |
| I-600 | H | Cl | H | O | 3-methoxyphenyl | 2-chloro-4,5,6,7-tetrahydro-1-benzo- | 4.18^{[a]} |
| | | | | | | thiophen-7-yl | |
| I-601 | H | Cl | H | O | 3-(trifluoromethyl)phenyl | [1-(4-methylphenyl)cyclopropyl]methyl | 4.58^{[a]} |
| I-602 | H | Cl | H | O | 3-(trifluoromethyl)phenyl | 2-[2-(1-methyl-1H-triazol-4-yl)phenyl] | 3.25^{[a]} |
| | | | | | | ethyl | |
| I-603 | H | Cl | H | O | 3-(trifluoromethyl)phenyl | naphthalen-2-ylmethyl | 4.23^{[a]} |
| I-604 | H | methyl | methyl | O | 3-(trifluoromethyl)phenyl | 2-(2,4-dimethylphenyl)-2,2-difluoroethyl | 3.65^{[a]} |
| I-605 | H | acetyl | H | O | 3-(trifluoromethyl)phenyl | rac-2-(4-bromo-2-chlorophenyl)-2- | 4.49^{[a]} |
| | | | | | | fluoroethyl | |
| (*) I-606 | H | methyl | H | O | 3-(trifluoromethyl)phenyl | rac-2-chloro-4,5,6,7-tetrahydro-1- | 4.20^{[a]} |
| | | | | | | benzothiophen-7-yl | |
| I-607 | H | Cl | H | O | 3-cyclopropyl-2- | 2-(4-bromo-2-chlorophenyl)-2,2- | 4.82^{[a]} |
| | | | | | fluorophenyl | difluoroethyl | |
| I-608 | H | Cl | H | O | 2-fluoro-3-methoxyphenyl | 2-chloro-4,5,6,7-tetrahydro-1- | 4.18^{[a]} |
| | | | | | | benzothiophen-7-yl | |
| I-609 | H | Cl | H | O | 3-(trifluoromethyl)phenyl | 2-[4-(difluoromethoxy)phenyl]ethyl | 3.85^{[a]} |
| I-610 | H | methyl | pyridin-2-yl | O | 3-(trifluoromethyl)phenyl | 2-(2,4-dimethylphenyl)-2,2-difluoroethyl | 3.85^{[a]}; |
| | | | | | | | 3.96^{[b]} |
| I-611 | H | Cl | H | O | 3-(trifluoromethyl)phenyl | 2-(4-methyl-2-pyridin-2-ylphenyl)ethyl | 3.81^{[a]} |
| I-612 | H | methyl | H | O | 3-cyclopropylphenyl | rac-2-(4-bromo-2-chlorophenyl)-2- | 4.29^{[a]} |
| | | | | | | fluoroethyl | |
| I-613 | H | methyl | H | O | 3-cyclopropyl-2- | 2-(2-methyl-1,3-benzoxazol-4-yl)ethyl | 3.06^{[a]} |
| | | | | | fluorophenyl | | |
| I-614 | H | methyl | H | O | 3-(trifluoromethyl)phenyl | rac-6-(oxan-4-yl)-1,2,3,4- | 3.83^{[a]} |
| | | | | | | tetrahydronaphthalen-1-yl | |
| I-615 | H | Cl | H | O | 3-(trifluoromethyl)phenyl | 2-(2,3-dimethylphenyl)-2,2-difluoroethyl | 4.46^{[a]} |
| I-616 | H | Cl | H | O | 3-(difluoromethyl)phenyl | 2-(4-chlorophenyl)-2,2-difluoroethyl | 3.85^{[a]} |
| I-617 | H | Cl | H | O | 3-(trifluoromethyl)phenyl | rac-2-methyl-4,5,6,7-tetrahydro-1- | 4.36^{[a]} |
| | | | | | | benzothiophen-7-yl | |
| I-618 | H | Cl | H | O | 3-methoxyphenyl | 2-(4-bromo-2-chlorophenyl)-2,2- | 4.27^{[a]} |
| | | | | | | difluoroethyl | |
| I-619 | H | Cl | H | O | 3-(difluoromethyl)-2- | rac-2-(4-bromo-2-chlorophenyl)-2- | 4.18^{[a]} |
| | | | | | fluorophenyl | fluoroethyl | |
| I-620 | H | methyl | H | O | 3-cyclopropylphenyl | 2-(2,4-dichlorophenyl)-2,2-difluoroethyl | 4.26^{[a]} |
| I-621 | H | methyl | H | O | 3-(trifluoromethyl)phenyl | rac-6-cyclopropyl-1,2,3,4- | 4.32^{[a]} |
| | | | | | | tetrahydronaphthalen-1-yl | |
| I-622 | H | Cl | H | O | 3-(trifluoromethyl)phenyl | 2-(3,4-dimethylphenyl)-2,2-difluoroethyl | 4.44^{[a]} |
| I-623 | H | 3-chloropyridin- | H | O | 2,3-difluorophenyl | 2-(2,4-dimethylphenyl)-2,2-difluoroethyl | 4.01^{[a]} |
| | | 4-yl | | | | | |
| I-624 | H | Cl | H | O | 3-(trifluoromethyl)phenyl | 2-(2-cyclopropyl-4-methylphenyl)ethyl | 4.76^{[a]} |
| I-625 | H | methyl | H | O | 3-cyclopropylphenyl | 2-(2,4-dimethylphenyl)-2,2-difluoroethyl | 4.14^{[a]} |
| I-626 | H | Cl | H | O | 2-fluoro-3-methoxyphenyl | rac-7-bromo-1,2,3,4-tetrahydro- | 4.13^{[a]} |
| | | | | | | naphthalen-1-yl | |
| I-627 | H | Cl | H | O | 3-(trifluoromethyl)phenyl | 2,2-difluoro-2-(2-fluoro-4,6- | 4.34^{[a]} |
| | | | | | | dimethylphenyl)ethyl | |
| I-628 | H | methyl | H | O | 3-(trifluoromethyl)phenyl | 2-[2-(trifluoromethyl)phenyl]cyclopropyl | 3.77^{[a]} |
| I-629 | H | Cl | H | O | 3-methoxyphenyl | rac-2-(4-bromo-2-chlorophenyl)-2- | 4.23^{[a]} |
| | | | | | | fluoroethyl | |
| I-630 | H | Cl | H | O | 3-(difluoromethyl)-2- | 2-(4-bromo-2-chlorophenyl)-2,2- | 4.20^{[a]} |
| | | | | | fluorophenyl | difluoroethyl | |
| I-631 | H | Cl | H | O | 3-(trifluoromethyl)phenyl | 2-(2-ethynyl-4-methylphenyl)ethyl | 4.24^{[a]} |
| I-632 | H | methyl | H | O | 3-cyclopropyl-2- | rac-2-(4-bromo-2-chlorophenyl)-2- | 4.36^{[a]} |
| | | | | | fluorophenyl | fluoroethyl | |
| I-633 | H | Cl | H | O | 3-(trifluoromethyl)phenyl | 2-[2-chloro-4-(trifluoromethyl)phenoxy]- | 4.58^{[a]} |
| | | | | | | 2,2-difluoroethyl | |
| I-634 | H | methyl | H | O | 3-(trifluoromethyl)phenyl | 1-[(4-chlorophenyl)methyl]cyclopropyl | 3.73^{[a]} |
| I-635 | H | Cl | H | O | 3-(trifluoromethyl)phenyl | 2-(5-chloropyrimidin-2-yl)ethyl | 3.05^{[a]} |
| I-636 | H | cyclopropyl | 2-methoxyethyl | O | 3-(trifluoromethyl)phenyl | 2-(2,4-dimethylphenyl)-2,2-difluoroethyl | 4.57^{[a]} |
| (*) I-637 | H | Cl | H | O | 3-(difluoromethyl)-2- | rac-2-(2,4-dichlorophenyl)-2-fluoroethyl | 4.08^{[a]} |
| | | | | | fluorophenyl | | |
| I-638 | H | methyl | H | O | 3-cyclopropyl-2- | 2-(2,4-dichlorophenyl)-2,2-difluoroethyl | 4.34^{[a]} |
| | | | | | fluorophenyl | | |
| I-639 | H | Cl | H | O | 3-(trifluoromethyl)phenyl | rac-2-chloro-4,5,6,7-tetrahydro-1- | 4.68^{[a]} |
| | | | | | | benzothiophen-4-yl | |
| I-640 | H | Cl | H | O | 3-cyclopropylphenyl | 2-(4-bromo-2-chlorophenyl)-2,2- | 4.90^{[a]} |
| | | | | | | difluoroethyl | |
| I-641 | H | methyl | H | O | 3-(trifluoromethyl)phenyl | 1-[(4-methoxyphenyl)methyl]cyclopropyl | 3.30^{[a]} |
| I-642 | H | cyclopropyl | methyl | O | 3-(trifluoromethyl)phenyl | 2-(2,4-dichlorophenyl)-2,2-difluoroethyl | 4.43^{[a]} |
| I-643 | H | 3-chloropyridin- | H | O | 3-(trifluoromethyl)phenyl | rac-2-(2,4-dichlorophenyl)-2-fluoroethyl | 4.41^{[a]} |
| | | 4-yl | | | | | |
| I-644 | H | methyl | H | O | 3-cyclopropyl-2- | 2-(2,4-dimethylphenyl)-2,2-difluoroethyl | 4.21^{[a]} |
| | | | | | fluorophenyl | | |
| I-645 | H | Cl | cyclopropylamino | O | 3-cyclopropyl-2- | 2-(2,4-dimethylphenyl)-2,2-difluoroethyl | 4.21^{[a]} |
| | | | | | fluorophenyl | | |
| I-646 | H | Cl | H | O | 2,3-difluorophenyl | 1-[3-(trifluoromethyl)phenyl]ethyl | 3.76^{[a]} |
| I-647 | H | Cl | H | O | 3-(trifluoromethyl)phenyl | rac-2-(4-chlorophenyl)-2-fluorocyclopropyl | 4.11^{[a]} |
| I-648 | H | Cl | cyclopropylamino | O | 3-(trifluoromethyl)phenyl | 2-(2,4-dimethylphenyl)-2,2-difluoroethyl | 4.19^{[a]} |
| I-649 | H | pyridin-4-yl | methyl | O | 3-(trifluoromethyl)phenyl | 2-(2,4-dimethylphenyl)-2,2-difluoroethyl | 3.44^{[a]} |
| I-650 | H | cyclopropyl | cyclopropylamino | O | 3-(trifluoromethyl)phenyl | 2-(2,4-dimethylphenyl)-2,2-difluoroethyl | 4.10^{[a]} |
| I-651 | H | 3-chloropyridin- | H | O | 3-(trifluoromethyl)phenyl | rac-2-(4-bromo-2-chlorophenyl)-2- | 4.49^{[a]} |
| | | 4-yl | | | | fluoroethyl | |
| I-652 | H | Cl | H | O | 5-cyclopropylpyridin-3-yl | 2-(4-bromo-2-chlorophenyl)-2,2- | 3.63^{[a]}; |
| | | | | | | difluoroethyl | 3.94^{[b]} |
| I-653 | H | H | 2-methoxyethyl | O | 3-(trifluoromethyl)phenyl | 2-(2,4-dimethylphenyl)-2,2-difluoroethyl | 3.94^{[a]} |
| I-654 | H | 3-chloropyridin- | H | O | 3-(trifluoromethyl)phenyl | 2-(2,4-dichlorophenyl)-2,2-difluoroethyl | 4.46^{[a]} |
| | | 4-yl | | | | | |
| I-655 | H | Cl | methyl | O | 3-cyclopropyl-2- | 2-(2,4-dimethylphenyl)-2,2-difluoroethyl | 4.49^{[a]} |
| | | | | | fluorophenyl | | |
| I-656 | H | Cl | H | O | 2-fluoro-3-methoxyphenyl | rac-2-methyl-4,5,6,7-tetrahydro-1- | 3.96^{[a]} |
| | | | | | | benzothiophen-7-yl | |
| I-657 | H | Cl | isopropyl | O | 3-(trifluoromethyl)phenyl | 2-(4-bromo-2-chlorophenyl)-2,2- | 5.17^{[a]} |
| | | | | | | difluoroethyl | |
| I-658 | H | Cl | H | O | 5-cyclopropylpyridin-3-yl | 2-(4-chlorophenyl)-2,2-difluoroethyl | 3.19^{[a]}; |
| | | | | | | | 3.50^{[b]} |
| I-659 | H | pyridin-4-yl | methyl | O | 3-(trifluoromethyl)phenyl | 2-(2,4-dichlorophenyl)-2,2-difluoroethyl | 3.55^{[a]} |
| I-660 | H | 3-chloropyridin- | cyclopropylamino | O | 3-(trifluoromethyl)phenyl | 2-(4-chlorophenyl)-2,2-difluoroethyl | 4.03^{[a]}; |
| | | 4-yl | | | | | 4.15^{[b]} |
| I-661 | H | 3-chloropyridin- | H | O | 3-(trifluoromethyl)phenyl | 2-(4-bromo-2-chlorophenyl)-2,2- | 4.54^{[a]} |
| | | 4-yl | | | | difluoroethyl | |
| I-662 | H | 2-cyanoethyl | H | O | 3-(trifluoromethyl)phenyl | 2-(2,4-dimethylphenyl)-2,2-difluoroethyl | 3.78^{[a]} |
| I-663 | H | Cl | methyl | O | 3-bromo-2-fluorophenyl | rac-2-(2-chloro-4-cyclopropylphenyl)-2- | 4.55^{[a]} |
| | | | | | | fluoroethyl | |
| I-664 | H | Cl | F | O | 3-cyclopropyl-2- | 2-(2,4-dimethylphenyl)-2,2-difluoroethyl | 4.74^{[a]} |
| | | | | | fluorophenyl | | |
| I-665 | H | Cl | H | O | 3-(1- | rac-2-(2,4-dichlorophenyl)-2-fluoroethyl | 4.56^{[a]} |
| | | | | | fluorocyclopropyl)phenyl | | |
| I-666 | H | Cl | H | O | 3-(rac-2,2- | 2-(2,4-dimethylphenyl)ethyl | 4.39^{[a]} |
| | | | | | difluorocyclopropyl)phenyl | | |
| I-667 | H | Cl | methyl | O | 3-bromo-2-fluorophenyl | 2-(2-chloro-4-methylphenyl)-2,2- | 4.33^{[a]} |
| | | | | | | difluoroethyl | |
| I-668 | H | Cl | methyl | O | 3-bromo-2-fluorophenyl | 2-(4-bromo-2-methylphenyl)-2,2- | 4.59^{[a]} |
| | | | | | | difluoroethyl | |
| I-669 | H | Cl | methyl | O | 3-bromo-2-fluorophenyl | rac-2-(2-chloro-4-methylphenyl)-2- | 4.26^{[a]} |
| | | | | | | fluoroethyl | |
| I-670 | H | Cl | methyl | O | 3-bromo-2-fluorophenyl | rac-2-(2,4-dimethylphenyl)-2-fluoroethyl | 4.23^{[a]} |
| I-671 | H | Cl | methyl | O | 3-bromo-2-fluorophenyl | rac-2-(4-bromo-2-chlorophenyl)-2- | 4.47^{[a]} |
| | | | | | | fluoroethyl | |
| I-672 | H | Cl | H | O | 3-(3-fluoroprop-1-en-2- | rac-2-(2,4-dichlorophenyl)-2-fluoroethyl | 4.39^{[a]} |
| | | | | | yl)phenyl | | |
| I-673 | H | methyl | H | O | 3-(trifluoromethyl)phenyl | (2,4-dimethylphenoxy)methyl | 3.79^{[a]} |
| I-674 | H | methyl | H | O | 3-(trifluoromethyl)phenyl | (4-chlorophenoxy)methyl | 3.55^{[a]} |
| I-675 | H | Cl | H | O | 3-ethynyl-2-fluorophenyl | rac-2-(4-bromo-2-chlorophenyl)-2- | 4.30^{[a]} |
| | | | | | | fluoroethyl | |
| I-676 | H | Cl | H | O | 2-fluoro-3-prop-1-en-1- | rac-2-(4-bromo-2-chlorophenyl)-2- | 5.00^{[a]} |
| | | | | | ylphenyl | fluoroethyl | |
| I-677 | H | Cl | H | O | 3-ethynyl-2-fluorophenyl | rac-2-(2,4-dichlorophenyl)-2-fluoroethyl | 4.18^{[a]} |
| I-678 | H | Cl | H | O | 5-(difluoromethyl)pyridin- | rac-2-(4-bromo-2-chlorophenyl)-2- | 3.54^{[a]} |
| | | | | | 3-yl | fluoroethyl | |
| I-679 | H | Cl | 4-carboxybutyl | O | 3-(trifluoromethyl)phenyl | 2-(2,4-dimethylphenyl)-2,2-difluoroethyl | 3.81^{[a]} |
| I-680 | H | Cl | H | O | 5-(difluoromethyl)pyridin- | 2-(2,4-dimethylphenyl)-2,2-difluoroethyl | 3.46^{[a]} |
| | | | | | 3-yl | | |
| I-681 | H | Cl | H | O | 3-ethynyl-2-fluorophenyl | 2-(2,4-dimethylphenyl)-2,2-difluoroethyl | 4.13^{[a]} |
| I-682 | H | Cl | H | O | 5-(trifluoromethyl)-3- | rac-2-(4-bromo-2-chlorophenyl)-2- | 4.72^{[a]} |
| | | | | | thienyl | fluoroethyl | |
| I-683 | H | Cl | rac-(2,2- | O | 3-(trifluoromethyl)phenyl | 2-(2,4-dimethylphenyl)-2,2-difluoroethyl | 4.95^{[a]} |
| | | | difluorocyclo- | | | | |
| | | | propyl)methoxy | | | | |
| I-684 | H | Cl | allyloxy | O | 3-(trifluoromethyl)phenyl | 2-(2,4-dimethylphenyl)-2,2-difluoroethyl | 4.87^{[a]} |
| I-685 | H | (cyclopropyl- | H | O | 3-(trifluoromethyl)phenyl | 2-(2,4-dimethylphenyl)-2,2-difluoroethyl | 3.39^{[a]} |
| | | amino)carbonyl | | | | | |
| I-686 | H | Cl | H | O | 2-fluoro-3-[rac-oxiran-2- | 2-(2,4-dimethylphenyl)-2,2-difluoroethyl | 3.96^{[a]} |
| | | | | | yl]phenyl | | |
| I-687 | H | Cl | 2-ethoxyethoxy | O | 3-(trifluoromethyl)phenyl | 2-(2,4-dimethylphenyl)-2,2-difluoroethyl | 4.72^{[a]} |
| I-688 | H | Cl | (E)-4,4,4-trifluoro- | O | 3-(trifluoromethyl)phenyl | 2-(2,4-dimethylphenyl)-2,2-difluoroethyl | 5.14^{[a]} |
| | | | but-2-enoxy | | | | |
| I-689 | CN | Cl | methyl | O | 3-(trifluoromethyl)phenyl | 2-(4-chlorophenyl)ethyl | 4.77^{[a]} |
| I-690 | H | Cl | methyl | O | 5-(difluoromethyl)pyridin- | 2-(2,4-dimethylphenyl)-2,2-difluoroethyl | 3.46^{[a]} |
| | | | | | 3-yl | | |
| I-691 | H | methyl | H | O | 3-(trifluoromethyl)phenyl | 2-(4-methyl-1H-pyrazol-1-yl)ethyl | 2.58^{[a]} |
| I-692 | H | Cl | methyl | O | 2-fluoro-3-vinylphenyl | 2-(2,4-dimethylphenyl)-2,2-difluoroethyl | 4.41^{[a]} |
| I-693 | H | Cl | methyl | O | 3-(1- | 2-(2,4-dimethylphenyl)ethyl | 4.20^{[a]} |
| | | | | | fluorocyclopropyl)phenyl | | |
| I-694 | H | Cl | methyl | O | 3-(rac-2,2- | 2-(2,4-dimethylphenyl)ethyl | 4.13^{[a]} |
| | | | | | difluorocyclopropyl)phenyl | | |
| I-695 | H | Cl | methyl | O | 3-(rac-2,2- | 2-(2,4-dimethylphenyl)-2,2-difluoroethyl | 4.30^{[a]} |
| | | | | | difluorocyclopropyl)phenyl | | |
| I-696 | H | Cl | methyl | O | 3-(rac-2,2- | rac-2-(2,4-dichlorophenyl)-2-fluoroethyl | 4.27^{[a]} |
| | | | | | difluorocyclopropyl)phenyl | | |
| I-697 | OH | Cl | H | O | 3-(trifluoromethyl)phenyl | 2-(4-chlorophenyl)ethyl | 3.74^{[a]} |
| I-698 | H | Cl | H | O | 2-fluoro-3-[rac-oxiran-2- | rac-2-(4-bromo-2-chlorophenyl)-2- | 4.15^{[a]} |
| | | | | | yl]phenyl | fluoroethyl | |
| (*) I-699 | H | Cl | H | O | 3-(rac-2- | 2-(2,4-dimethylphenyl)-2,2-difluoroethyl | 4.47^{[a]} |
| | | | | | fluorocyclopropyl)phenyl | | |
| (*) I-700 | H | Cl | H | O | 3-(rac-2- | 2-(2,4-dimethylphenyl)-2,2-difluoroethyl | 4.37^{[a]} |
| | | | | | fluorocyclopropyl)phenyl | | |
| I-701 | H | Cl | H | O | 2-fluoro-3-[rac-oxiran-2- | rac-2-(2,4-dichlorophenyl)-2-fluoroethyl | 4.08^{[a]} |
| | | | | | yl]phenyl | | |
| I-702 | H | methyl | (2-methyl-1,3- | O | 3-cyclopropyl-2- | 2-(2,4-dimethylphenyl)-2,2-difluoroethyl | 3.82^{[a]} |
| | | | dioxolan-4- | | fluorophenyl | | |
| | | | yl)methylamino | | | | |
| (*) I-703 | H | Cl | methyl | O | 3-cyclopropyl-2- | 2-(2,4-dichlorophenyl)-2-fluoroethyl | 4.51^{[a]} |
| | | | | | fluorophenyl | | |
| (*) I-704 | H | Cl | methyl | O | 3-cyclopropyl-2- | 2-(2,4-dichlorophenyl)-2-fluoroethyl | 4.51^{[a]} |
| | | | | | fluorophenyl | | |
| (*) I-705 | H | cyclopropyl | H | O | 3-(trifluoromethyl)phenyl | 2-(4-bromo-2-chlorophenyl)-2-fluoroethyl | 4.85^{[a]} |
| (*) I-706 | H | cyclopropyl | H | O | 3-(trifluoromethyl)phenyl | 2-(4-bromo-2-chlorophenyl)-2-fluoroethyl | 4.85^{[a]} |
| I-707 | H | Cl | methyl | O | 3-(trifluoromethyl)phenyl | rac-2-(3,4-dimethylphenyl)-2-fluoroethyl | 4.30^{[a]} |
| I-708 | H | Cl | methyl | O | 3-(trifluoromethyl)phenyl | rac-2-[4-(difluoromethyl)-2-methyl- | 4.05^{[a]} |
| | | | | | | phenyl]-2-fluoroethyl | |
| I-709 | H | Cl | methyl | O | 3-(trifluoromethyl)phenyl | rac-2-(2-chloro-4-methylphenyl)-2- | 4.40^{[a]} |
| | | | | | | fluoroethyl | |
| I-710 | H | Cl | methyl | O | 3-(trifluoromethyl)phenyl | rac-2-(4-chloro-2-methylphenyl)-2- | 4.44^{[a]} |
| | | | | | | fluoroethyl | |
| I-711 | H | Cl | methyl | O | 3-(trifluoromethyl)phenyl | rac-2-(2-chloro-4-cyclopropylphenyl)-2- | 4.70^{[a]} |
| | | | | | | fluoroethyl | |
| I-712 | H | Cl | methyl | O | 3-(trifluoromethyl)phenyl | rac-2-(4-bromo-2-methylphenyl)-2- | 4.55^{[a]} |
| | | | | | | fluoroethyl | |
| I-713 | H | Cl | methyl | O | 3-cyclopropyl-2- | rac-2-(3,4-dimethylphenyl)-2-fluoroethyl | 4.40^{[a]} |
| | | | | | fluorophenyl | | |
| I-714 | H | Cl | methyl | O | 3-cyclopropyl-2- | rac-2-[4-(difluoromethyl)-2-methylphenyl]- | 4.12^{[a]} |
| | | | | | fluorophenyl | 2-fluoroethyl | |
| I-715 | H | Cl | methyl | O | 3-cyclopropyl-2- | rac-2-(4-chloro-3-methoxyphenyl)-2- | 4.08^{[a]} |
| | | | | | fluorophenyl | fluoroethyl | |
| I-716 | H | Cl | methyl | O | 3-cyclopropyl-2- | rac-2-(3,4-dichlorophenyl)-2-fluoroethyl | 4.51^{[a]} |
| | | | | | fluorophenyl | | |
| I-717 | H | Cl | methyl | O | 3-cyclopropyl-2- | rac-2-(2-chloro-4-methylphenyl)-2- | 4.47^{[a]} |
| | | | | | fluorophenyl | fluoroethyl | |
| I-718 | H | Cl | methyl | O | 3-cyclopropyl-2- | rac-2-(4-chloro-2-methylphenyl)-2- | 4.55^{[a]} |
| | | | | | fluorophenyl | fluoroethyl | |
| I-719 | H | Cl | methyl | O | 3-cyclopropyl-2- | rac-2-(2-chloro-4-cyclopropylphenyl)-2- | 4.78^{[a]} |
| | | | | | fluorophenyl | fluoroethyl | |
| I-720 | H | Cl | methyl | O | 3-cyclopropyl-2- | rac-2-(4-bromo-2-methylphenyl)-2- | 4.66^{[a]} |
| | | | | | fluorophenyl | fluoroethyl | |
| (*) I-721 | H | Cl | H | O | 3-cyclopropyl-2- | 2-(4-bromo-2-chlorophenyl)-2-fluoroethyl | 5.00^{[a]} |
| | | | | | fluorophenyl | | |
| (*) I-722 | H | Cl | H | O | 3-cyclopropyl-2- | 2-(4-bromo-2-chlorophenyl)-2-fluoroethyl | 5.00^{[a]} |
| | | | | | fluorophenyl | | |
| (*) I-723 | H | Cl | methyl | O | 3-methoxyphenyl | 2-(2,4-dichlorophenyl)-2-fluoroethyl | 3.94^{[a]} |
| (*) I-724 | H | Cl | methyl | O | 3-methoxyphenyl | 2-(2,4-dichlorophenyl)-2-fluoroethyl | 3.94^{[a]} |
| (*) I-725 | H | methyl | methyl | O | 3-chlorophenyl | 2-(4-bromo-2-chlorophenyl)-2-fluoroethyl | 3.81^{[a]} |
| (*) I-726 | H | methyl | methyl | O | 3-chlorophenyl | 2-(4-bromo-2-chlorophenyl)-2-fluoroethyl | 3.81^{[a]} |
| I-727 | H | Cl | H | O | 1-benzothiophen-6-yl | 2-(2,4-dimethylphenyl)-2,2-difluoroethyl | 4.47^{[a]} |
| I-728 | H | Cl | H | O | 6,7-dihydro-5H- | 2-(2,4-dimethylphenyl)-2,2-difluoroethyl | 3.40^{[a]} |
| | | | | | cyclopenta[b]pyridin-3-yl | | |
| (*) I-729 | H | Cl | H | O | 2,3-difluorophenyl | 2-(4-bromo-2-chlorophenyl)-2-fluoroethyl | 4.37^{[a]} |
| (*) I-730 | H | Cl | H | O | 2,3-difluorophenyl | 2-(4-bromo-2-chlorophenyl)-2-fluoroethyl | 4.37^{[a]} |
| I-731 | H | Cl | H | O | 3-ethyl-2-fluorophenyl | 2-(2,4-dimethylphenyl)-2,2-difluoroethyl | 4.85^{[a]} |
| I-732 | H | Cl | H | O | rac-indan-1-yl | 2-(2,4-dimethylphenyl)-2,2-difluoroethyl | 5.16^{[a]} |
| (*) I-733 | H | Cl | H | O | 3-cyclopropylphenyl | 2-(2,4-dichlorophenyl)-2-fluoroethyl | 4.85^{[a]} |
| (*) I-734 | H | Cl | H | O | 3-cyclopropylphenyl | 2-(2,4-dichlorophenyl)-2-fluoroethyl | 4.85^{[a]} |
| (*) I-735 | H | methyl | H | O | 2-fluoro-3- | 2-(4-bromo-2-chlorophenyl)-2-fluoroethyl | 4.33^{[a]} |
| | | | | | (trifluoromethyl)phenyl | | |
| (*) I-736 | H | methyl | H | O | 2-fluoro-3- | 2-(4-bromo-2-chlorophenyl)-2-fluoroethyl | 4.33^{[a]} |
| | | | | | (trifluoromethyl)phenyl | | |
| I-737 | H | Cl | methyl | O | 2-fluoro-3-[rac-2,2- | 2-(2,4-dimethylphenyl)-2,2-difluoroethyl | 4.37^{[a]} |
| | | | | | difluorocyclopropyl]phenyl | | |
| I-738 | H | Cl | methyl | O | 2-fluoro-3-[rac-2,2- | rac-2-(2,4-dichlorophenyl)-2-fluoroethyl | 4.33^{[a]} |
| | | | | | difluorocyclopropyl]phenyl | | |
| I-739 | methoxy | Cl | methyl | O | 3-cyclopropyl-2- | 2-(2,4-dichlorophenyl)ethyl | 5.36^{[a]} |
| | | | | | fluorophenyl | | |
| I-740 | methoxy | Cl | H | O | 3-cyclopropyl-2- | 2-(2,4-dichlorophenyl)ethyl | 5.12^{[a]} |
| | | | | | fluorophenyl | | |
| (*) I-741 | H | methyl | methyl | O | 3-(trifluoromethyl)phenyl | 2-(2,4-dichlorophenyl)-2-fluoroethyl | 3.88^{[a]} |
| (*) I-742 | H | methyl | methyl | O | 3-(trifluoromethyl)phenyl | 2-(2,4-dichlorophenyl)-2-fluoroethyl | 3.88^{[a]} |
| (*) I-743 | H | Cl | H | O | 3-(difluoromethyl)-2- | 2-(2,4-dichlorophenyl)-2-fluoroethyl | 4.26^{[a]} |
| | | | | | fluorophenyl | | |
| (*) I-744 | H | Cl | H | O | 3-(difluoromethyl)-2- | 2-(2,4-dichlorophenyl)-2-fluoroethyl | 4.26^{[a]} |
| | | | | | fluorophenyl | | |
| I-745 | methoxy | methyl | H | O | 3-cyclopropylphenyl | 2-(2,4-dimethylphenyl)ethyl | 4.26^{[a]} |
| | methyl | | | | | | |
| I-746 | H | Cl | methyl | O | 3-cyclopropyl-2- | 2-(2-chloro-4-methylphenyl)-2,2- | 4.55^{[a]} |
| | | | | | fluorophenyl | difluoroethyl | |
| I-747 | H | Cl | methyl | O | 3-cyclopropyl-2- | 2-(4-chloro-2-methylphenyl)-2,2- | 4.74^{[a]} |
| | | | | | fluorophenyl | difluoroethyl | |
| I-748 | H | Cl | methyl | O | 3-cyclopropyl-2- | 2-(4-bromo-2-methylphenyl)-2,2- | 4.81^{[a]} |
| | | | | | fluorophenyl | difluoroethyl | |
| I-749 | H | Cl | methyl | O | 3-cyclopropyl-2- | 2-(3,4-dimethylphenyl)-2,2-difluoroethyl | 4.51^{[a]} |
| | | | | | fluorophenyl | | |
| I-750 | H | Cl | methyl | O | 3-(difluoromethyl)-2- | 2-(2,4-dimethylphenyl)-2,2-difluoroethyl | 4.19^{[a]} |
| | | | | | fluorophenyl | | |
| I-751 | H | Cl | I | O | 3-cyclopropyl-2- | 2-(2,4-dimethylphenyl)-2,2-difluoroethyl | 4.67^{[a]} |
| | | | | | fluorophenyl | | |
| I-752 | ethoxy | Cl | methyl | O | 3-cyclopropyl-2- | benzyl | 4.55^{[a]} |
| | | | | | fluorophenyl | | |
| I-753 | 2- | Cl | methyl | O | 3-cyclopropyl-2- | benzyl | 5.20^{[a]} |
| | methyl- | | | | fluorophenyl | | |
| | propoxy | | | | | | |
| I-754 | H | methyl | H | O | 3-cyclopropylphenyl | rac-1-cyano-2-(2,4-dimethylphenyl)ethyl | 3.94^{[a]} |
| I-755 | H | oxan-4-yl | H | O | 3-(trifluoromethyl)phenyl | 2-(2,4-dimethylphenyl)-2,2-difluoroethyl | 4.11^{[a]} |
| I-756 | H | Cl | cyclopropylamino | O | 3-cyclopropyl-2- | rac-2-(2,4-dichlorophenyl)-2-fluoroethyl | 4.34^{[a]} |
| | | | | | fluorophenyl | | |
| I-757 | H | Cl | methylamino | O | 3-cyclopropyl-2- | 2-(2,4-dichlorophenyl)ethyl | 4.09^{[a]} |
| | | | | | fluorophenyl | | |
| I-758 | H | Cl | I | O | 3-cyclopropyl-2- | rac-2-(2,4-dichlorophenyl)-2-fluoroethyl | 4.73^{[a]} |
| | | | | | fluorophenyl | | |
| I-759 | H | Cl | I | O | 3-cyclopropyl-2- | 2-(2,4-dichlorophenyl)ethyl | 4.81^{[a]} |
| | | | | | fluorophenyl | | |
| I-760 | H | methyl | cyclopropylamino | O | 3-cyclopropyl-2- | 2-(2,4-dimethylphenyl)-2,2-difluoroethyl | 3.68^{[a]} |
| | | | | | fluorophenyl | | |
| I-761 | H | Cl | methylamino | O | 3-cyclopropyl-2- | rac-2-(2,4-dichlorophenyl)-2-fluoroethyl | 4.11^{[a]} |
| | | | | | fluorophenyl | | |
| I-762 | H | Cl | H | O | 3-cyclopropyl-2- | rac-2-(2,4-dimethylphenyl)-2-fluoroethyl | 4.61^{[a]} |
| | | | | | fluorophenyl | | |
| I-763 | H | Cl | methyl | O | 3-(trifluoromethyl)phenyl | rac-2-(2,4-dimethylphenyl)-2-fluoroethyl | 4.25^{[a]} |
| I-764 | H | Cl | H | O | 2-fluoro-3-(1- | 2-(2,4-dimethylphenyl)-2,2-difluoroethyl | 4.55^{[a]} |
| | | | | | fluorocyclopropyl)phenyl | | |
| I-765 | H | Cl | H | O | 2-fluoro-3-(1- | rac-2-(2,4-dichlorophenyl)-2-fluoroethyl | 4.59^{[a]} |
| | | | | | fluorocyclopropyl)phenyl | | |
| I-766 | H | Cl | methyl | O | 2-fluoro-3-(1- | 2-(2,4-dimethylphenyl)-2,2-difluoroethyl | 4.40^{[a]} |
| | | | | | fluorocyclopropyl)phenyl | | |
| I-767 | H | methylsulfanyl | H | O | 3-(trifluoromethyl)phenyl | 2-(2,4-dimethylphenyl)-2,2-difluoroethyl | 4.72^{[a]} |
| I-768 | H | ethylsulfanyl | H | O | 3-(trifluoromethyl)phenyl | 2-(2,4-dimethylphenyl)-2,2-difluoroethyl | 5.08^{[a]} |
| I-769 | H | Cl | H | O | 1H-indol-5-yl | 2-(2,4-dimethylphenyl)-2,2-difluoroethyl | 3.78^{[a]} |
| I-770 | H | Cl | H | O | 3-ethynylphenyl | rac-2-(4-bromo-2-chlorophenyl)-2- | 4.30^{[a]} |
| | | | | | | fluoroethyl | |
| I-771 | H | rac-ethylsulfinyl | H | O | 3-(trifluoromethyl)phenyl | 2-(2,4-dimethylphenyl)-2,2-difluoroethyl | 3.83^{[a]} |
| I-772 | H | methyl | H | O | 3-(trifluoromethyl)phenyl | (Z)-2-(2,4-dimethylphenyl)ethen-1-yl | 4.54^{[a]} |
| I-773 | H | Cl | methyl | O | 3-cyclopropyl-2- | rac-2-(2,4-dimethylphenyl)-2-fluoroethyl | 4.37^{[a]} |
| | | | | | fluorophenyl | | |
| I-774 | H | I | methyl | O | 3-(trifluoromethyl)phenyl | 2-(2,4-dimethylphenyl)-2,2-difluoroethyl | 4.59^{[a]} |
| I-775 | H | methyl | methylamino | O | 3-cyclopropyl-2- | 2-(2,4-dimethylphenyl)-2,2-difluoroethyl | 3.29^{[a]} |
| | | | | | fluorophenyl | | |
| I-776 | H | methyl | methylamino | O | 3-cyclopropyl-2- | rac-2-(2,4-dichlorophenyl)-2-fluoroethyl | 3.31^{[a]} |
| | | | | | fluorophenyl | | |
| I-777 | H | Cl | methyl | O | 3-(trifluoromethyl)phenyl | 2-(4,5-dimethyl-3-thienyl)ethyl | 4.08^{[a]} |
| I-778 | H | Cl | methyl | O | 3-(trifluoromethyl)phenyl | rac-2-methyl-4,5,6,7-tetrahydro-1- | 4.30^{[a]} |
| | | | | | | benzothiophen-7-yl | |
| I-779 | H | methyl | methoxy | O | 3-cyclopropyl-2- | 2-(2,4-dimethylphenyl)-2,2-difluoroethyl | 4.01^{[a]} |
| | | | | | fluorophenyl | | |
| I-780 | H | Cl | H | O | 2-fluoro-3-vinylphenyl | 2-(2,4-dimethylphenyl)-2,2-difluoroethyl | 4.53^{[a]} |
| I-781 | H | rac-methyl- | H | O | 3-(trifluoromethyl)phenyl | 2-(2,4-dimethylphenyl)-2,2-difluoroethyl | 3.65^{[a]} |
| | | sulfinyl | | | | | |
| I-782 | H | Cl | OH | O | 3-cyclopropyl-2- | rac-2-(2,4-dichlorophenyl)-2-fluoroethyl | 5.13^{[a]} |
| | | | | | fluorophenyl | | |
| I-783 | H | Cl | methoxy | O | 3-cyclopropyl-2- | rac-2-(2,4-dichlorophenyl)-2-fluoroethyl | 4.51^{[a]} |
| | | | | | fluorophenyl | | |
| I-784 | H | Cl | methyl | O | 3-chloro-2-fluorophenyl | 2-(2,4-dimethylphenyl)-2,2-difluoroethyl | 4.37^{[a]} |
| I-785 | prop-1- | Cl | H | O | 3-(trifluoromethyl)phenyl | 2-(2,4-dimethylphenyl)-2,2-difluoroethyl | 5.51^{[a]} |
| | en-2- | | | | | | |
| | yloxy- | | | | | | |
| | carbonyl | | | | | | |
| I-786 | H | Cl | methyl | O | 3-chloro-2-fluorophenyl | 2-(4-cyclopropyl-2-methylphenyl)-2,2- | 4.62^{[a]} |
| | | | | | | difluoroethyl | |
| I-787 | H | Cl | methyl | O | 3-cyclopropyl-2- | 2-(2,4-dimethylphenyl)ethyl | 4.44^{[a]} |
| | | | | | fluorophenyl | | |
| I-788 | H | Cl | methyl | O | 3-chloro-2-fluorophenyl | 2-(2-chloro-4-methylphenyl)-2,2- | 4.26^{[a]} |
| | | | | | | difluoroethyl | |
| I-789 | H | Cl | methyl | O | 3-chloro-2-fluorophenyl | 2-(4-chloro-2-methylphenyl)-2,2- | 4.47^{[a]} |
| | | | | | | difluoroethyl | |
| I-790 | H | Cl | methyl | O | 3-chlorophenyl | 2-(2,4-dimethylphenyl)-2,2-difluoroethyl | 4.27^{[a]} |
| I-791 | H | Cl | H | O | 2-fluoro-3-vinylphenyl | rac-2-(2,4-dichlorophenyl)-2-fluoroethyl | 4.63^{[a]} |
| I-792 | H | Cl | H | O | 3-acetylphenyl | rac-2-(4-bromo-2-chlorophenyl)-2- | 3.81^{[a]} |
| | | | | | | fluoroethyl | |
| I-793 | H | 1-(tert- | H | O | 3-(trifluoromethyl)phenyl | 2-(2,4-dimethylphenyl)-2,2-difluoroethyl | 4.64^{[a]} |
| | | butoxycarbonyl) | | | | | |
| | | azetidin-3-yl | | | | | |
| I-794 | H | rac-oxolan-3-yl | H | O | 3-(trifluoromethyl)phenyl | 2-(2,4-dimethylphenyl)-2,2-difluoroethyl | 3.78^{[a]} |
| I-795 | H | 3,3,3-trifluoropropyl | H | O | 3-(trifluoromethyl)phenyl | 2-(2,4-dimethylphenyl)-2,2-difluoroethyl | 4.51^{[a]} |
| I-796 | H | 2-methoxyethyl | H | O | 3-(trifluoromethyl)phenyl | 2-(2,4-dimethylphenyl)-2,2-difluoroethyl | 4.00^{[a]} |
| I-797 | H | benzyl | H | O | 3-(trifluoromethyl)phenyl | 2-(2,4-dimethylphenyl)-2,2-difluoroethyl | 4.95^{[a]} |
| I-798 | H | cyclobutylmethyl | H | O | 3-(trifluoromethyl)phenyl | 2-(2,4-dimethylphenyl)-2,2-difluoroethyl | 5.02^{[a]} |
| I-799 | H | (cyclopropylamino) | methyl | O | 3-(trifluoromethyl)phenyl | 2-(2,4-dimethylphenyl)-2,2-difluoroethyl | 3.92^{[a]} |
| | | carbonyl | | | | | |
| I-800 | H | methyl | methyl | S | 3-(trifluoromethyl)phenyl | rac-2-(2,4-dichlorophenyl)-2-fluoroethyl | 4.63^{[a]} |
| I-801 | H | propylamino- | methyl | O | 3-(trifluoromethyl)phenyl | 2-(2,4-dimethylphenyl)-2,2-difluoroethyl | 4.25^{[a]} |
| | | carbonyl | | | | | |
| I-802 | H | 2-hydroxyethyl | H | O | 3-(trifluoromethyl)phenyl | 2-(2,4-dimethylphenyl)-2,2-difluoroethyl | 3.35^{[a]} |
| I-803 | H | 3-ethoxy-3- | H | O | 3-(trifluoromethyl)phenyl | 2-(2,4-dimethylphenyl)-2,2-difluoroethyl | 4.37^{[a]} |
| | | oxopropyl | | | | | |
| I-804 | H | Cl | 2- | O | 3-(trifluoromethyl)phenyl | 2-(2,4-dimethylphenyl)-2,2-difluoroethyl | 4.56^{[a]} |
| | | | methylsulfanyl- | | | | |
| | | | ethylamino | | | | |
| I-805 | H | Cl | (2-methyl-1,3- | O | 3-(trifluoromethyl)phenyl | 2-(2,4-dimethylphenyl)-2,2-difluoroethyl | 4.37^{[a]} |
| | | | dioxolan-4- | | | | |
| | | | yl)methylamino | | | | |
| I-806 | H | Cl | rac-but-3-en-2-yl- | O | 3-(trifluoromethyl)phenyl | 2-(2,4-dimethylphenyl)-2,2-difluoroethyl | 4.72^{[a]} |
| | | | amino | | | | |
| I-807 | H | Cl | 2-methoxyethyl- | O | 3-(trifluoromethyl)phenyl | 2-(2,4-dimethylphenyl)-2,2-difluoroethyl | 4.25^{[a]} |
| | | | amino | | | | |
| I-808 | H | Cl | 2-methoxyethylthio | O | 3-(trifluoromethyl)phenyl | 2-(2,4-dimethylphenyl)-2,2-difluoroethyl | 4.64^{[a]} |
| I-809 | H | Cl | 2- | O | 3-(trifluoromethyl)phenyl | 2-(2,4-dimethylphenyl)-2,2-difluoroethyl | 4.95^{[a]} |
| | | | cyclopropylethyl- | | | | |
| | | | amino | | | | |
| I-810 | H | Cl | (1- | O | 3-(trifluoromethyl)phenyl | 2-(2,4-dimethylphenyl)-2,2-difluoroethyl | 4.56^{[a]} |
| | | | methylcyclo- | | | | |
| | | | propyl)amino | | | | |
| I-811 | H | Cl | 2,2,2-trifluoro- | O | 3-(trifluoromethyl)phenyl | 2-(2,4-dimethylphenyl)-2,2-difluoroethyl | 4.92^{[a]} |
| | | | ethylthio- | | | | |
| I-812 | H | Cl | (2- | O | 3-(trifluoromethyl)phenyl | 2-(2,4-dimethylphenyl)-2,2-difluoroethyl | 4.87^{[a]} |
| | | | cyclopropylcyclo- | | | | |
| | | | propyl)amino | | | | |
| I-813 | H | Cl | H | O | 2,3-dihydro-1-benzofuran- | 2-(2,4-dimethylphenyl)-2,2-difluoroethyl | 3.96^{[a]} |
| | | | | | 5-yl | | |
| I-814 | H | Cl | H | O | 3-(methoxymethyl)phenyl | 2-(2,4-dimethylphenyl)-2,2-difluoroethyl | 3.99^{[a]} |
| I-815 | H | Cl | H | O | 3-cyano-2-fluorophenyl | 2-(2,4-dimethylphenyl)-2,2-difluoroethyl | 3.79^{[a]} |
| I-816 | H | Cl | H | O | 2-fluoro-3-methylphenyl | 2-(2,4-dimethylphenyl)-2,2-difluoroethyl | 4.37^{[a]} |
| I-817 | H | Cl | H | O | 3-methylphenyl | 2-(2,4-dimethylphenyl)-2,2-difluoroethyl | 4.34^{[a]} |
| I-818 | H | Cl | H | O | 2-fluoro-3- | 2-(2,4-dimethylphenyl)-2,2-difluoroethyl | 4.37^{[a]} |
| | | | | | methylsulfanylphenyl | | |
| I-819 | H | Cl | H | O | 3- | 2-(2,4-dimethylphenyl)-2,2-difluoroethyl | 4.88^{[a]} |
| | | | | | (trifluoromethylthio)phenyl | | |
| I-820 | H | Cl | H | O | 2-fluoro-3- | 2-(2,4-dimethylphenyl)-2,2-difluoroethyl | 4.66^{[a]} |
| | | | | | (trifluoromethoxy)phenyl | | |
| I-821 | H | Cl | morpholin-4-yl | O | 3-(trifluoromethyl)phenyl | 2-(2,4-dimethylphenyl)-2,2-difluoroethyl | 4.27^{[a]} |
| I-822 | H | Cl | methyl | O | 3-chlorophenyl | rac-2-(4-bromo-2-chlorophenyl)-2- | 4.37^{[a]} |
| | | | | | | fluoroethyl | |
| I-823 | H | methyl | H | O | 3-cyclopropyl-2- | rac-2-(2,4-dimethylphenyl)-2-fluoroethyl | 4.11^{[a]} |
| | | | | | fluorophenyl | | |
| I-824 | H | Cl | H | O | 3-(trifluoromethyl)phenyl | 2-(4,5-dimethyl-3-thienyl)ethyl | 4.32^{[a]} |
| I-825 | H | Cl | H | O | 3-(trifluoromethyl)phenyl | 2-(2,5-dichloro-3-thienyl)-2,2- | 4.73^{[a]} |
| | | | | | | difluoroethyl | |
| I-826 | H | Cl | H | O | 3-(trifluoromethyl)phenyl | 2-(5-methyl-2-furyl)ethyl | 3.79^{[a]} |
| I-827 | H | methyl | H | O | 3-cyclopropyl-2- | rac-2-(2,4-dimethylphenyl)-2- | 3.17^{[a]} |
| | | | | | fluorophenyl | hydroxyethyl | |
| I-828 | H | Cl | H | O | 5-ethyl-2- | 2-(2,4-dimethylphenyl)-2,2-difluoroethyl | 4.88^{[a]} |
| | | | | | (methoxycarbonyl)-3- | | |
| | | | | | thienyl | | |
| I-829 | H | Cl | H | O | 3-(1-cyanocyclopropyl)- | 2-(2,4-dimethylphenyl)-2,2-difluoroethyl | 3.94^{[a]} |
| | | | | | 2-fluorophenyl | | |
| I-830 | H | Cl | H | O | 1H-indol-6-yl | 2-(2,4-dimethylphenyl)-2,2-difluoroethyl | 3.90^{[a]} |
| I-831 | H | Cl | H | O | 3-(1- | 2-(2,4-dimethylphenyl)-2,2-difluoroethyl | 4.49^{[a]} |
| | | | | | fluorocyclopropyl)phenyl | | |
| I-832 | H | Cl | H | O | 3-(difluoromethoxy)-2- | 2-(2,4-dimethylphenyl)-2,2-difluoroethyl | 4.17^{w} |
| | | | | | fluorophenyl | | |
| I-833 | H | Cl | methyl | O | 3-bromo-2-fluorophenyl | 2-(4-cyclopropyl-2-methylphenyl)-2,2- | 4.66^{[a]} |
| | | | | | | difluoroethyl | |
| (*) I-834 | H | methyl | methyl | O | 3-chlorophenyl | rac-2-(4-bromo-2-chlorophenyl)-2- | 3.69^{[a]} |
| | | | | | | fluoroethyl | |
| I-835 | H | methyl | methyl | O | 3-cyclopropyl-2- | rac-2-(2-chloro-4-methylphenyl)-2- | 3.81^{[a]} |
| | | | | | fluorophenyl | fluoroethyl | |
| I-836 | H | methyl | methyl | O | 3-cyclopropyl-2- | rac-2-(2,4-dimethylphenyl)-2-fluoroethyl | 3.78^{[a]} |
| | | | | | fluorophenyl | | |
| I-837 | H | methyl | methyl | O | 3-cyclopropyl-2- | rac-2-(2-chloro-4-cyclopropylphenyl)-2- | 4.12^{[a]} |
| | | | | | fluorophenyl | fluoroethyl | |
| I-838 | H | methyl | methyl | O | 3-cyclopropyl-2- | 2-(2-chloro-4-methylphenyl)-2,2- | 3.91^{[a]} |
| | | | | | fluorophenyl | difluoroethyl | |
| I-839 | H | methyl | methyl | O | 3-cyclopropyl-2- | 2-(3,4-dimethylphenyl)-2,2-difluoroethyl | 3.87^{[a]} |
| | | | | | fluorophenyl | | |
| I-840 | H | Cl | methyl | O | 3-cyclopropyl-2- | 2-(2-bromo-4-methylphenyl)-2,2- | 4.57^{[a]} |
| | | | | | fluorophenyl | difluoroethyl | |
| I-841 | H | methyl | methyl | O | 3-(difluoromethyl)-2- | rac-2-(2-chloro-4-methylphenyl)-2- | 3.47^{[a]} |
| | | | | | fluorophenyl | fluoroethyl | |
| I-842 | H | methyl | methyl | O | 3-(difluoromethyl)-2- | 2-(4-bromo-2-methylphenyl)-2,2- | 3.81^{[a]} |
| | | | | | fluorophenyl | difluoroethyl | |
| I-843 | H | Cl | methyl | O | 3-chloro-2-fluorophenyl | 2-(3,4-dimethylphenyl)-2,2-difluoroethyl | 4.25^{[a]} |
| I-844 | H | Cl | methyl | O | 3-chloro-2-fluorophenyl | 2-(2-bromo-4-methylphenyl)-2,2- | 4.34^{[a]} |
| | | | | | | difluoroethyl | |

(*) Ex I-016 and I-024 are the 2 enantiomers of Ex I-288
(*) Ex I-142 is 1 enantiomer of Ex I-359
Ex I-142: Optical rotation: −46.4° (c = 1.04, DCM, 25° C.); concentration c is expressed in g/100 mL.
(*) Ex I-147 is 1 enantiomer of Ex I-378
Ex I-147: Optical rotation: +18° (c = 1, MeOH, 20° C.); concentration c is expressed in g/100 mL.
(*) Ex I-229 is 1 enantiomer of Ex I-195
(*) Ex I-245 is 1 enantiomer of Ex I-356
Ex I-245: Optical rotation: −20° (c = 1, DCM, 25° C.); concentration c is expressed in g/100 mL.
(*) Ex I-380 and I-392 are the 2 enantiomers of Ex I-606
(*) Ex I-438 and I-448 are two different diastereoisomers
(*) Ex I-091 is (S) Enantiomer and I-098 is (R) Enantiomer
(*) Ex I-703 and I-704 are the 2 enantiomers of Ex I-267
Ex I-703: Optical rotation: −48.1° (c = 0.92, CDC13, 25° C.); concentration c is expressed in g/100 mL.
Ex I-704: Optical rotation: +40.7° (c = 1.08, CDC13, 25° C.); concentration c is expressed in g/100 mL.
(*) Ex I-705 and I-706 are the 2 enantiomers of Ex I-255
Ex I-705: Optical rotation: +52.3° (c = 1.30, CDC13, 20° C.); concentration c is expressed in g/100 mL.
Ex I-706: Optical rotation: −45.5° (c = 1.32, CDC13, 20° C.); concentration c is expressed in g/100 mL.
(*) Ex I-721 and I-722 are the 2 enantiomers of Ex I-594
Ex I-721: Optical rotation: +54.4° (c = 1.03, CDC13, 25° C.); concentration c is expressed in g/100 mL.
Ex I-722: Optical rotation: −50.9° (c = 1.1, CDC13, 25° C.); concentration c is expressed in g/100 mL.
(*) Ex I-723 and I-724 are the 2 enantiomers of Ex I-533
Ex I-723: Optical rotation: +50.7° (c = 1.5, CDC13, 25° C.); concentration c is expressed in g/100 mL.
Ex I-724: Optical rotation: −52.9° (c = 1.55, CDC13, 25° C.); concentration c is expressed in g/100 mL.
(*) Ex I-725 and I-726 are the 2 enantiomers of Ex I-834
Ex I-725: Optical rotation: +41.9° (c = 1.05, CDC13, 25° C.); concentration c is expressed in g/100 mL.
Ex I-726: Optical rotation: −47° (c = 1.15, CDC13, 25° C.); concentration c is expressed in g/100 mL.
(*) Ex I-729 and I-730 are the 2 enantiomers of Ex I-407
Ex I-729: Optical rotation: +48.3° (c = 1.45, CDC13, 25° C.); concentration c is expressed in g/100 mL.
Ex I-730: Optical rotation: −49.7° (c = 1.45, CDC13, 25° C.); concentration c is expressed in g/100 mL.
(*) Ex I-733 and I-734 are the 2 enantiomers of Ex I-367
Ex I-733: Optical rotation: −57.1° (c = 1.16, CDC13, 20° C.); concentration c is expressed in g/100 mL.
Ex I-734: Optical rotation: +55.5° (c = 1.23, CDC13, 20° C.); concentration c is expressed in g/100 mL.
(*) Ex I-735 and I-736 are the 2 enantiomers of Ex I-233
Ex I-735: Optical rotation: −47.4° (c = 1.27, CDC13, 20° c.); concentration c is expressed in g/100 mL.
Ex I-736: Optical rotation: +55° (c = 1.09, CDC13, 20° c.); concentration c is expressed in g/100 mL.
(*) Ex I-741 and I-742 are the 2 enantiomers of Ex I-423
Ex I-741: Optical rotation: +39.8° (c = 1.16, CDC13, 25° c.); concentration c is expressed in g/100 mL.
Ex I-742: Optical rotation: −38.3° (c = 1.10, CDC13, 25° c.); concentration c is expressed in g/100 mL.
(*) Ex I-743 and I-744 are the 2 enantiomers of Ex I-637
Ex I-743: Optical rotation: +52.4° (c = 0.65, CDC13, 25° c.); concentration c is expressed in g/100 mL.
Ex I-744: Optical rotation: −46.7° (c = 0.69, CDC13, 25° c.); concentration c is expressed in g/100 mL.
(*) Ex I-438 and I-448 are two different diastereoisomers
(*) Ex I-699 and I-700 are two different diastereoisomers

TABLE 2
I-001: ¹H-NMR(400.2 MHz, d₆-DMSO):
δ = 8.8107 (1.9); 8.7970 (3.8); 8.7833 (2.0); 8.3165 (0.4); 8.0884 (16.0); 7.7558 (1.5); 7.7366 (4.8);
7.7171 (5.0); 7.7022 (6.2); 7.6828 (2.5); 7.6550 (7.0); 7.6181 (0.4); 7.5866 (4.1); 7.5661 (3.3); 7.5043
(8.2); 7.4992 (8.6); 7.3845 (6.3); 7.3638 (7.6); 7.3383 (0.5); 7.1510 (4.5); 7.1460 (4.6); 7.1305 (3.9);
7.1254 (3.9); 7.0066 (0.4); 7.0007 (0.4); 3.9025 (2.6); 3.5968 (2.5); 3.5803 (6.9); 3.5649 (7.0); 3.5485
(2.7); 3.5067 (0.5); 3.4896 (0.4); 3.3264 (161.0); 2.9776 (5.0); 2.9609 (9.7); 2.9440 (4.4); 2.9082
(0.6); 2.8930 (0.3); 2.6709 (2.3); 2.5057 (317.3); 2.5019 (387.2); 2.3286 (2.2); 2.2534 (0.3); 1.2979
(0.6); 1.2581 (0.9); 1.2335 (1.1); −0.0007 (1.1)
I-002: ¹H-NMR(300.2 MHz, d₆-DMSO):
δ = 9.1785 (5.5); 9.1628 (5.9); 9.1524 (1.4); 9.1319 (2.4); 9.1111 (1.2); 7.8252 (5.7); 7.8096 (5.5);
7.7985 (1.0); 7.7717 (2.8); 7.7458 (3.3); 7.7303 (3.7); 7.7049 (1.3); 7.6786 (4.0); 7.6218 (2.4); 7.5947
(1.7); 7.3465 (3.4); 7.3199 (3.9); 7.1036 (4.4); 6.9516 (2.4); 6.9251 (2.1); 4.1799 (1.2); 4.1595 (1.3);
4.1313 (2.8); 4.1101 (2.7); 4.0972 (0.9); 4.0814 (1.5); 4.0734 (2.0); 4.0609 (1.4); 4.0498 (1.7); 4.0259
(0.6); 3.3599 (89.4); 3.3375 (1.3); 2.5344 (25.6); 2.5285 (18.1); 2.4502 (11.3); 2.2500 (16.0); 2.0219
(6.7); 1.2694 (0.4); 1.2309 (1.8); 1.2072 (3.6); 1.1835 (1.8); 0.0327 (16.7); 0.0217 (0.6)
I-003: ¹H-NMR(300.2 MHz, CDCl3):
δ = 7.5782 (0.9); 7.5653 (0.8); 7.5336 (2.9); 7.5225 (3.1); 7.5161 (3.2); 7.4008 (1.2); 7.3963 (1.3);
7.3750 (1.7); 7.3706 (1.7); 7.3275 (2.8); 7.3180 (3.4); 7.2986 (11.6); 7.2613 (1.0); 7.2362 (2.4);
7.2104 (2.0); 7.2000 (2.0); 7.1960 (2.1); 7.1754 (0.8); 4.1701 (0.3); 4.1461 (0.3); 3.9709 (1.0); 3.9529
(1.9); 3.9315 (1.8); 3.9132 (1.0); 3.3334 (1.9); 3.3126 (2.2); 3.2932 (1.6); 2.6079 (0.6); 2.4944 (16.0);
2.3772 (15.2); 2.1243 (0.6); 2.0818 (2.3); 1.6144 (1.2); 1.3202 (0.6); 1.2963 (1.3); 1.2727 (0.4);
0.9731 (0.5); 0.1075 (2.8); 0.0377 (13.7)
I-004: ¹H-NMR(300.2 MHz, CDCl3):
δ = 8.8801 (5.5); 8.7013 (3.9); 8.6934 (3.9); 8.6233 (3.1); 8.6070 (3.2); 8.1063 (1.9); 8.0861 (2.7);
8.0677 (1.9); 8.0072 (2.0); 7.9899 (1.2); 7.7353 (0.7); 7.6895 (7.3); 7.6122 (0.4); 7.5747 (4.3); 7.5410
(2.0); 7.5304 (2.4); 7.5238 (2.3); 7.5117 (2.0); 7.3957 (3.3); 7.3692 (3.7); 7.2987 (7.6); 7.0850 (4.5);
6.9983 (2.5); 6.9715 (2.2); 4.3481 (1.6); 4.3284 (1.6); 4.2999 (3.3); 4.2803 (3.2); 4.2516 (1.8); 4.2321
(1.7); 2.5291 (12.1); 2.3216 (16.0); 1.2928 (0.5); 0.0370 (4.7)
I-005: ¹H-NMR(400.1 MHz, d₆-DMSO):
δ = 9.2222 (1.6); 9.2020 (1.7); 7.7554 (0.7); 7.7357 (2.0); 7.7160 (1.8); 7.6901 (2.3); 7.6707 (1.1);
7.6394 (2.8); 7.5946 (1.6); 7.5746 (1.2); 7.1221 (3.1); 7.0880 (1.2); 7.0685 (2.1); 7.0314 (3.1); 7.0120
(1.5); 5.1015 (0.9); 5.0830 (1.4); 5.0647 (0.9); 3.3284 (208.8); 2.8981 (1.5); 2.7395 (1.4); 2.5129
(7.1); 2.5088 (9.4); 2.5049 (7.0); 2.3471 (16.0); 2.1837 (0.4); 2.1731 (0.4); 2.1448 (12.8); 2.0469
(13.5); 1.4200 (6.7); 1.4026 (6.6)
I-006: ¹H-NMR(300.2 MHz, CDCl3):
δ = 8.2946 (11.9); 8.1686 (1.1); 8.1502 (1.5); 8.1300 (0.8); 8.0174 (3.6); 7.9875 (4.0); 7.9689 (1.9);
7.9486 (1.6); 7.9377 (2.1); 7.9260 (0.4); 7.9152 (0.4); 7.9034 (1.8); 7.8931 (1.5); 7.8721 (2.2); 7.6925
(3.9); 7.6849 (4.1); 7.6276 (0.5); 7.6208 (1.0); 7.6046 (3.2); 7.5982 (5.0); 7.5858 (5.4); 7.5732 (4.6);
7.5666 (6.2); 7.5508 (1.1); 7.5374 (4.9); 7.5179 (0.4); 7.5026 (3.9); 7.4991 (3.7); 7.4963 (3.8); 7.3640
(3.1); 7.3560 (3.0); 7.3344 (2.8); 7.3263 (2.7); 7.2985 (18.6); 7.2533 (2.4); 7.2467 (2.4); 7.2251 (2.0);
7.2184 (2.0); 5.3371 (1.7); 4.5118 (2.0); 4.4913 (1.9); 4.4640 (4.1); 4.4435 (4.0); 4.4161 (2.1); 4.3957
(2.0); 4.3629 (1.0); 2.8001 (0.4); 1.5878 (16.0); 1.2953 (3.2); 0.9421 (0.4); 0.9213 (1.0); 0.8976 (0.5);
0.1098 (0.7); 0.0502 (0.7); 0.0394 (17.8); 0.0286 (0.8)
I-007: ¹H-NMR(400.0 MHz, CD3CN):
δ = 7.9751 (5.5); 7.7515 (0.5); 7.7212 (0.5); 7.7015 (1.4); 7.6819 (2.1); 7.6762 (2.0); 7.6565 (0.5);
7.5619 (1.8); 7.5008 (3.2); 7.4788 (2.9); 7.0353 (1.8); 7.0291 (1.9); 6.7473 (1.1); 6.7410 (1.0); 6.7252
(1.0); 6.7189 (1.0); 4.3426 (1.0); 4.3264 (1.0); 4.3085 (2.2); 4.2922 (2.2); 4.2743 (1.2); 4.2580 (1.1);
3.8729 (0.4); 3.7269 (16.0); 2.1444 (6.0); 2.0923 (0.7); 2.0858 (31.8); 1.9713 (0.6); 1.9636 (0.4);
1.9576 (0.9); 1.9517 (5.1); 1.9455 (9.2); 1.9393 (12.5); 1.9332 (8.5); 1.9270 (4.4)
I-008: ¹H-NMR(300.2 MHz, CDCl3):
δ = 9.2567 (1.1); 8.5764 (1.2); 8.3948 (16.0); 8.1448 (1.5); 7.9650 (4.9); 7.8949 (3.4); 7.8666 (5.0);
7.7524 (3.8); 7.7467 (3.6); 7.7241 (2.6); 7.7184 (2.6); 7.7001 (2.4); 7.6814 (2.3); 7.6397 (6.9); 7.6223
(8.3); 7.5949 (0.4); 7.5140 (3.9); 7.4790 (0.4); 7.4661 (1.7); 7.4579 (1.7); 7.4539 (1.3); 7.4499 (2.7);
7.4437 (2.2); 7.4360 (1.4); 7.4277 (1.0); 7.2985 (31.8); 5.3366 (14.7); 4.9694 (7.8); 4.9496 (7.8);
2.0815 (1.5); 1.6437 (3.3); 1.3194 (0.3); 1.2954 (1.2); 1.2811 (0.4); 1.2717 (0.4); 0.1072 (1.9); 0.0477
(1.0); 0.0370 (31.9); 0.0260 (1.1)
I-009: ¹H-NMR(300.2 MHz, CDCl3):
δ = 7.8360 (2.6); 7.8304 (2.6); 7.7772 (2.6); 7.7690 (2.6); 7.5743 (1.3); 7.5592 (1.4); 7.5534 (4.1);
7.5500 (3.5); 7.5369 (0.3); 7.5328 (0.3); 7.4545 (2.4); 7.4404 (1.0); 7.4304 (1.3); 7.4226 (0.7); 7.4164
(0.5); 7.4096 (0.8); 7.4021 (0.4); 7.2988 (2.6); 7.2887 (1.8); 7.2621 (2.0); 7.0324 (2.0); 6.9269 (1.6);
6.9044 (1.6); 6.5727 (1.8); 6.5662 (2.3); 6.5646 (2.3); 6.5581 (1.8); 4.0578 (0.9); 4.0372 (0.8); 4.0091
(1.8); 3.9884 (1.8); 3.9603 (0.9); 3.9396 (0.9); 2.5488 (16.0); 2.4386 (5.9); 2.4317 (3.4); 2.2827 (7.9);
2.0733 (0.5); 1.2953 (0.6); 1.2917 (0.6); 0.1119 (3.8); 0.0384 (2.5)
I-010: ¹H-NMR(300.2 MHz, CDCl3):
δ = 7.5623 (1.1); 7.5330 (6.1); 7.5038 (6.8); 7.4521 (2.6); 7.4265 (1.6); 7.3961 (6.1); 7.3674 (3.9);
7.3138 (3.2); 7.2986 (9.4); 7.2917 (2.2); 7.2880 (1.7); 7.2683 (1.4); 7.2649 (1.5); 7.2610 (1.3); 7.2573
(1.0); 6.8676 (1.9); 6.6800 (3.9); 6.5430 (0.9); 6.5223 (1.7); 6.5013 (1.0); 6.4924 (2.3); 4.2450 (1.7);
4.2240 (1.6); 4.1978 (3.6); 4.1768 (3.4); 4.1505 (1.9); 4.1296 (1.7); 2.0708 (0.4); 1.6239 (16.0);
1.2896 (0.4); 0.0361 (5.1)
I-011: ¹H-NMR(300.2 MHz, CDCl3):
δ = 8.9565 (5.8); 8.5241 (4.2); 8.4522 (2.5); 8.4359 (2.7); 8.0462 (0.5); 8.0274 (0.9); 8.0085 (0.5);
7.8990 (2.5); 7.8828 (2.4); 7.6901 (1.7); 7.6709 (4.0); 7.6681 (4.0); 7.5594 (2.2); 7.5301 (1.0); 7.5197
(1.4); 7.5125 (1.2); 7.4997 (1.1); 7.4922 (0.7); 7.3990 (2.1); 7.3724 (2.3); 7.3530 (0.4); 7.2988 (17.8);
7.2437 (0.4); 7.0812 (2.4); 6.9946 (1.2); 6.9685 (1.2); 4.3444 (1.0); 4.3246 (1.0); 4.2962 (2.1); 4.2765
(2.0); 4.2476 (1.2); 4.2282 (1.0); 4.1950 (0.5); 4.1713 (1.4); 4.1475 (1.4); 4.1238 (0.5); 4.0704 (16.0);
4.0473 (0.4); 3.9022 (1.3); 3.7424 (1.7); 2.5285 (6.5); 2.4401 (0.4); 2.3671 (0.8); 2.3196 (9.0); 2.0834
(5.9); 1.6344 (2.1); 1.3210 (1.6); 1.2971 (3.3); 1.2734 (1.5); 0.1076 (0.5); 0.0483 (0.6); 0.0374 (17.9);
0.0270 (0.7)
I-012: ¹H-NMR(300.2 MHz, CDCl3):
δ = 7.8771 (0.5); 7.8572 (0.8); 7.8382 (0.5); 7.5602 (0.3); 7.5337 (1.2); 7.5081 (3.1); 7.4997 (2.0);
7.4852 (2.4); 7.4485 (1.0); 7.4418 (1.5); 7.4307 (2.0); 7.4176 (0.9); 7.4041 (2.0); 7.2986 (4.5); 7.0877
(2.0); 7.0414 (1.1); 7.0148 (1.0); 4.2639 (0.9); 4.2437 (0.9); 4.2136 (1.8); 4.1934 (1.8); 4.1632 (1.0);
4.1431 (0.9); 3.7400 (1.6); 3.7206 (3.2); 3.7009 (1.9); 3.3673 (16.0); 3.0136 (1.6); 2.9941 (2.8);
2.9747 (1.4); 2.7043 (10.9); 2.5371 (6.0); 2.5306 (3.5); 2.3245 (8.0); 1.6471 (4.6); 1.2938 (0.4);
0.0373 (4.4)
I-013: ¹H-NMR(400.0 MHz, d₆-DMSO):
δ = 8.9487 (1.9); 7.9534 (0.6); 7.7770 (4.6); 7.7437 (0.5); 7.7244 (1.2); 7.7046 (0.9); 7.6583 (3.3);
7.6390 (0.8); 7.5948 (1.1); 7.5766 (0.7); 7.4720 (0.3); 7.4651 (2.9); 7.4603 (1.2); 7.4485 (1.2); 7.4434
(4.0); 7.4368 (0.6); 7.3188 (0.5); 7.3121 (4.0); 7.3072 (1.3); 7.2953 (1.0); 7.2904 (3.1); 3.3854 (64.3);
2.8927 (3.8); 2.7341 (3.2); 2.6157 (11.7); 2.5161 (4.8); 2.5117 (10.1); 2.5072 (13.6); 2.5027 (10.0);
2.4983 (4.9); 1.6178 (16.0)
I-014: ¹H-NMR(499.9 MHz, CDCl3):
δ = 8.2582 (10.2); 7.9246 (1.0); 7.9143 (1.7); 7.9040 (1.0); 7.6398 (0.4); 7.6234 (5.3); 7.6131 (7.1);
7.4768 (3.9); 7.4375 (0.4); 7.4294 (1.3); 7.4244 (1.5); 7.4208 (2.1); 7.4170 (2.0); 7.4116 (1.5); 7.4067
(1.1); 7.3188 (3.4); 7.3028 (3.7); 7.2579 (2.0); 7.0344 (4.3); 6.9398 (2.3); 6.9239 (2.1); 4.2397 (1.6);
4.2278 (1.6); 4.2109 (3.5); 4.1990 (3.4); 4.1820 (1.8); 4.1701 (1.7); 2.4664 (11.6); 2.2770 (16.0);
2.0378 (0.4); 1.6111 (1.7); −0.0002 (1.9)
I-015: ¹H-NMR(300.2 MHz, CDCl3):
δ = 7.5793 (1.3); 7.5585 (3.6); 7.5415 (0.4); 7.5205 (1.9); 7.4916 (3.1); 7.4828 (1.8); 7.4317 (1.6);
7.3729 (0.7); 7.3636 (1.2); 7.3566 (0.8); 7.3418 (0.8); 7.3343 (0.5); 7.2988 (19.8); 7.1607 (1.1);
7.1540 (1.1); 7.1325 (0.9); 7.1258 (0.9); 6.8718 (0.8); 5.3383 (2.7); 4.4303 (0.9); 4.4094 (0.8); 4.3814
(1.8); 4.3607 (1.8); 4.3328 (0.9); 4.3120 (0.9); 3.0174 (0.5); 3.0050 (0.7); 2.9961 (0.7); 2.9835 (0.5);
2.2095 (1.0); 1.5889 (16.0); 1.2927 (0.5); 0.9258 (0.4); 0.9018 (1.8); 0.8847 (1.8); 0.8789 (1.5);
0.8609 (0.6); 0.7222 (0.6); 0.7059 (1.6); 0.6985 (1.8); 0.6935 (1.5); 0.6871 (1.3); 0.6700 (0.4); 0.0484
(0.7); 0.0376 (17.6); 0.0267 (0.7)
I-016: ¹H-NMR(300.2 MHz, CDCl3):
δ = 8.0869 (4.1); 8.0261 (0.4); 7.6498 (0.9); 7.6290 (2.6); 7.5165 (1.2); 7.4622 (1.6); 7.4544 (0.9);
7.4472 (0.6); 7.4332 (3.3); 7.4266 (1.4); 7.2993 (37.6); 7.2667 (1.1); 7.2597 (1.0); 7.2389 (0.8);
7.2325 (0.9); 6.1332 (0.3); 6.1206 (0.3); 5.9776 (0.3); 5.9651 (0.3); 5.9542 (0.3); 3.8371 (0.4); 3.8207
(0.4); 2.2766 (0.4); 2.2692 (0.4); 2.2513 (0.8); 2.2344 (0.4); 2.2250 (0.4); 1.5765 (16.0); 1.2018 (1.8);
1.1878 (2.9); 1.1801 (1.5); 1.1674 (1.0); 1.1618 (1.7); 1.1531 (0.7); 0.0499 (1.3); 0.0391 (38.4);
0.0298 (1.2); 0.0282 (1.4)
I-017: ¹H-NMR(400.0 MHz, d₆-DMSO):
δ = 8.7978 (2.0); 7.9527 (0.4); 7.7595 (4.7); 7.7406 (0.5); 7.7207 (1.3); 7.7014 (1.0); 7.6571 (2.7);
7.6353 (0.8); 7.5965 (1.0); 7.5773 (0.7); 7.3678 (0.3); 7.3599 (3.2); 7.3549 (1.2); 7.3431 (1.0); 7.3378
(3.6); 7.3300 (0.4); 6.8176 (0.4); 6.8097 (3.6); 6.8047 (1.2); 6.7928 (1.0); 6.7876 (3.4); 6.7797 (0.4);
3.7090 (15.5); 3.3521 (25.3); 3.3487 (26.5); 3.3469 (27.0); 2.8904 (3.0); 2.7319 (2.7); 2.6114 (12.0);
2.5123 (5.9); 2.5079 (12.4); 2.5034 (16.9); 2.4988 (12.2); 2.4943 (5.9); 1.6151 (16.0); −0.0002 (0.4)
I-018: ¹H-NMR(400.2 MHz, d₆-DMSO):
δ = 9.0625 (0.8); 9.0469 (1.6); 9.0310 (0.7); 8.3102 (0.8); 7.7362 (0.7); 7.7165 (1.9); 7.6968 (1.6);
7.6683 (2.1); 7.6584 (6.4); 7.6488 (1.1); 7.5756 (2.5); 7.5299 (1.4); 7.5099 (1.1); 7.4879 (2.4); 7.4675
(2.6); 7.3753 (3.0); 7.0568 (1.5); 7.0360 (1.4); 4.2668 (0.7); 4.2511 (0.7); 4.2314 (1.5); 4.2158 (1.4);
4.1959 (0.8); 4.1801 (0.7); 3.3251 (248.3); 2.7115 (0.4); 2.6759 (0.8); 2.6714 (1.1); 2.6670 (0.8);
2.5779 (16.0); 2.5418 (85.8); 2.5110 (68.8); 2.5069 (131.0); 2.5024 (169.1); 2.4979 (126.4); 2.4937
(64.7); 2.4534 (0.8); 2.4455 (0.9); 2.4247 (0.5); 2.4175 (0.5); 2.3678 (0.4); 2.3337 (0.8); 2.3293 (1.1);
2.3247 (0.8); 1.7637 (1.0); 1.7560 (1.1); 1.7358 (1.6); 1.6948 (0.9); 1.6663 (2.3); 1.3301 (0.9); 1.3015
(2.5); 1.2802 (3.1); 1.2578 (1.2); 1.2533 (1.2); 1.2240 (0.6); 1.2013 (0.5); 1.1939 (0.5); 1.1779 (0.3);
1.1708 (0.4); −0.0003 (1.5)
I-019: ¹H-NMR(400.0 MHz, CD3CN):
δ = 8.0424 (16.0); 7.9978 (0.5); 7.8328 (1.1); 7.7418 (1.0); 7.7223 (3.5); 7.7036 (6.9); 7.6801 (1.1);
7.5698 (4.7); 7.5201 (1.8); 7.5155 (3.1); 7.5107 (1.8); 7.4970 (2.3); 7.2210 (0.4); 7.1857 (11.3);
7.0864 (4.8); 5.4757 (0.6); 4.6765 (0.3); 4.1884 (2.9); 4.1724 (2.8); 4.1534 (6.2); 4.1374 (6.0); 4.1183
(3.1); 4.1023 (3.0); 2.4224 (0.4); 2.3762 (0.9); 2.3604 (2.0); 2.3046 (0.6); 2.2660 (57.6); 2.2493
(173.0); 2.2456 (113.2); 2.2432 (158.1); 2.2370 (239.3); 2.1370 (0.4); 1.9939 (1.7); 1.9878 (3.8);
1.9819 (22.5); 1.9758 (41.1); 1.9696 (55.7); 1.9634 (38.2); 1.9573 (19.6); 1.7981 (0.3); 1.4568 (0.3);
1.4392 (0.7); 1.4215 (0.3)
I-020: ¹H-NMR(300.2 MHz, CDCl3):
δ = 7.6131 (0.4); 7.5837 (4.0); 7.5784 (3.0); 7.5696 (6.7); 7.5663 (8.1); 7.5518 (0.6); 7.4740 (3.5);
7.4537 (0.6); 7.4402 (1.6); 7.4313 (1.4); 7.4263 (2.3); 7.4157 (4.4); 7.4017 (1.1); 7.3891 (4.1); 7.2986
(23.3); 7.0821 (4.0); 6.9966 (2.1); 6.9695 (1.9); 6.3355 (0.9); 6.3155 (1.7); 6.2946 (0.9); 4.3078 (2.0);
4.2872 (2.0); 4.2592 (4.3); 4.2386 (4.1); 4.2105 (2.2); 4.1900 (2.1); 2.5270 (12.0); 2.5199 (6.8);
2.3578 (0.4); 2.3437 (0.4); 2.3079 (16.0); 2.0786 (0.8); 1.6230 (1.2); 1.5909 (10.0); 1.2951 (0.8);
0.1084 (2.2); 0.0492 (0.8); 0.0385 (23.7); 0.0276 (0.8)
I-021: ¹H-NMR(400.1 MHz, d₆-DMSO):
δ = 9.2042 (6.1); 8.3131 (16.0); 8.3103 (15.3); 7.8559 (12.6); 7.7956 (2.0); 7.7763 (6.4); 7.7567 (7.4);
7.7441 (10.8); 7.7260 (4.5); 7.6973 (11.1); 7.6138 (6.3); 7.5954 (5.7); 7.5056 (6.2); 7.4848 (9.2);
7.3778 (7.6); 7.3570 (6.1); 4.3250 (2.8); 4.3127 (3.4); 4.2920 (6.2); 4.2785 (6.6); 4.2580 (3.7); 4.2440
(3.4); 3.3014 (21.7); 3.2987 (20.8); 2.5385 (0.4); 2.5006 (30.8); 2.4973 (32.4); 2.0722 (4.1); 2.0691
(3.8); −0.0002 (7.3); −0.0034 (6.7)
I-022: ¹H-NMR(300.2 MHz, CDCl3):
δ = 8.6534 (4.2); 8.6386 (2.5); 8.6217 (2.4); 8.4961 (8.9); 8.0835 (0.7); 8.0643 (1.2); 8.0445 (0.7);
7.7306 (0.4); 7.7038 (2.1); 7.6846 (5.5); 7.6814 (5.1); 7.5833 (2.6); 7.5695 (0.5); 7.5534 (1.2); 7.5430
(1.6); 7.5356 (1.4); 7.5229 (1.1); 7.5149 (0.6); 7.4538 (2.8); 7.4370 (2.7); 7.3989 (2.5); 7.3722 (2.8);
7.2985 (15.8); 7.0857 (2.8); 7.0013 (1.6); 6.9747 (1.4); 4.3441 (1.3); 4.3244 (1.3); 4.2958 (2.7);
4.2761 (2.6); 4.2474 (1.4); 4.2278 (1.3); 2.5275 (8.4); 2.5204 (4.8); 2.4699 (16.0); 2.3240 (11.4);
2.0832 (0.9); 1.2966 (1.1); 0.1077 (0.6); 0.0478 (0.6); 0.0371 (16.1); 0.0262 (0.6)
I-023: ¹H-NMR(400.0 MHz, d₆-DMSO):
δ = 9.3497 (3.0); 9.3299 (3.0); 8.2081 (16.0); 7.9533 (0.5); 7.8882 (6.0); 7.8757 (2.7); 7.8710 (3.0);
7.8606 (5.7); 7.8533 (3.5); 7.8396 (5.3); 7.7540 (5.4); 7.7473 (4.8); 7.7258 (4.1); 7.7092 (4.6); 7.6877
(3.9); 7.6639 (5.3); 7.6409 (2.1); 7.5805 (3.5); 7.5764 (3.5); 7.5592 (3.1); 7.5551 (3.1); 7.4844 (0.9);
7.4805 (1.3); 7.4674 (3.3); 7.4633 (3.0); 7.4556 (3.4); 7.4498 (6.6); 7.4439 (3.2); 7.4363 (2.8); 7.4323
(3.0); 7.4191 (1.1); 7.4152 (0.8); 5.3414 (0.4); 5.3235 (1.8); 5.3054 (2.6); 5.2871 (1.8); 5.2689 (0.4);
3.3520 (164.4); 2.8902 (3.0); 2.7324 (2.8); 2.5264 (0.8); 2.5128 (19.0); 2.5086 (39.4); 2.5042 (52.6);
2.4998 (38.1); 2.4955 (18.5); 1.5598 (13.0); 1.5423 (12.9); 1.2383 (1.3); −0.0002 (3.6)
I-024: ¹H-NMR(300.2 MHz, CDCl3):
δ = 8.0867 (12.1); 8.0259 (1.5); 7.6755 (0.6); 7.6493 (3.0); 7.6289 (8.0); 7.6262 (7.3); 7.5168 (3.9);
7.4810 (0.4); 7.4744 (0.5); 7.4619 (5.1); 7.4548 (3.2); 7.4472 (2.2); 7.4329 (10.7); 7.2997 (38.6);
7.2666 (3.2); 7.2599 (3.2); 7.2387 (2.3); 7.2322 (2.6); 6.1438 (1.0); 6.1331 (1.1); 6.1204 (1.0); 6.1102
(1.0); 5.9880 (1.0); 5.9776 (1.1); 5.9646 (1.1); 5.9539 (1.0); 5.3390 (15.6); 4.3556 (0.6); 4.3452 (0.6);
4.3335 (0.6); 4.3225 (0.6); 4.3068 (0.7); 4.2959 (0.7); 4.2850 (0.7); 4.2737 (0.7); 4.2662 (0.6); 4.2552
(0.6); 4.2436 (0.6); 4.2321 (0.6); 4.2171 (0.7); 4.2063 (0.7); 4.1947 (0.8); 4.1837 (0.7); 3.9091 (0.7);
3.8915 (0.7); 3.8852 (0.8); 3.8679 (0.7); 3.8605 (0.7); 3.8377 (1.3); 3.8204 (1.2); 3.7975 (0.7); 3.7896
(0.7); 3.7723 (0.6); 3.7662 (0.6); 3.7489 (0.6); 2.2949 (0.6); 2.2767 (1.0); 2.2690 (1.3); 2.2608 (0.9);
2.2515 (2.6); 2.2405 (1.0); 2.2339 (1.2); 2.2253 (1.3); 2.2078 (0.7); 1.5813 (16.0); 1.2952 (0.9);
1.2016 (6.1); 1.1926 (6.8); 1.1877 (9.5); 1.1805 (5.6); 1.1675 (3.4); 1.1618 (5.5); 1.1534 (2.6); 1.1304
(0.5); 0.9210 (0.4); 0.0496 (1.6); 0.0392 (40.5)
I-025: ¹H-NMR(300.2 MHz, CDCl3):
δ = 9.3970 (4.0); 9.0571 (16.0); 8.1441 (1.6); 8.1248 (2.8); 8.1055 (1.6); 7.6311 (1.1); 7.6048 (5.2);
7.5943 (4.4); 7.5850 (13.5); 7.5817 (12.0); 7.5688 (1.2); 7.5647 (1.2); 7.4700 (7.4); 7.4407 (15.6);
7.3789 (13.4); 7.3635 (5.4); 7.3501 (8.5); 7.3355 (2.2); 7.2991 (4.6); 4.1637 (3.5); 4.1435 (3.4);
4.1170 (7.4); 4.0968 (7.2); 4.0703 (3.7); 4.0501 (3.6); 2.6976 (0.6); 2.6853 (1.3); 2.6748 (1.9); 2.6629
(2.7); 2.6557 (2.7); 2.6435 (2.0); 2.6332 (1.4); 2.6209 (0.6); 1.7644 (1.4); 1.2926 (1.0); 1.0176 (1.9);
0.9989 (5.8); 0.9944 (7.4); 0.9769 (7.7); 0.9716 (6.0); 0.9543 (2.4); 0.9236 (0.4); 0.9012 (0.4); 0.7781
(0.3); 0.7371 (2.6); 0.7235 (5.8); 0.7205 (6.3); 0.7137 (7.1); 0.7083 (6.4); 0.7026 (6.0); 0.6849 (1.9);
0.0347 (3.8)
I-026: ¹H-NMR(400.0 MHz, d₆-DMSO):
δ = 8.9018 (1.9); 7.9533 (0.4); 7.7774 (4.6); 7.7415 (0.5); 7.7215 (1.2); 7.7026 (0.9); 7.6561 (3.2);
7.6364 (0.8); 7.5951 (1.0); 7.5771 (0.7); 7.4828 (1.5); 7.4775 (0.7); 7.4692 (1.7); 7.4605 (1.9); 7.4523
(0.8); 7.4470 (1.7); 7.0841 (1.8); 7.0789 (0.6); 7.0619 (3.4); 7.0449 (0.5); 7.0396 (1.6); 3.3573 (18.7);
3.3511 (29.1); 3.3478 (29.2); 2.8914 (2.8); 2.7325 (2.6); 2.6144 (11.4); 2.5133 (5.9); 2.5089 (12.4);
2.5044 (16.6); 2.4998 (12.0); 2.4954 (5.8); 1.6263 (16.0); −0.0002 (0.3)
I-027: ¹H-NMR(300.2 MHz, CDCl3):
δ = 7.5950 (0.4); 7.5690 (1.5); 7.5457 (4.3); 7.5272 (0.5); 7.5222 (0.5); 7.4363 (2.1); 7.3796 (0.9);
7.3713 (1.5); 7.3639 (1.1); 7.3558 (3.3); 7.3488 (3.8); 7.2983 (8.4); 7.2454 (2.2); 7.2180 (3.0); 7.0767
(1.9); 7.0697 (1.8); 7.0494 (1.4); 7.0424 (1.3); 6.1817 (0.5); 6.1624 (0.9); 6.1436 (0.5); 4.1651 (0.7);
4.1413 (0.7); 3.8674 (1.1); 3.8456 (3.0); 3.8243 (3.1); 3.8023 (1.2); 3.1281 (2.1); 3.1057 (4.1); 3.0833
(1.9); 2.6461 (0.6); 2.6388 (0.4); 2.6190 (16.0); 2.3269 (15.9); 2.2242 (0.4); 2.0776 (3.1); 1.6132
(8.2); 1.3177 (1.1); 1.2939 (2.5); 1.2701 (0.9); 0.9183 (0.7); 0.0469 (0.4); 0.0362 (8.5)
I-028: ¹H-NMR(400.2 MHz, d₆-DMSO):
δ = 9.0621 (0.6); 9.0464 (1.4); 9.0307 (0.6); 8.3094 (1.4); 7.7381 (0.6); 7.7181 (1.8); 7.6982 (1.5);
7.6712 (1.8); 7.6570 (6.7); 7.5842 (2.2); 7.5252 (1.2); 7.5045 (1.0); 7.4895 (2.4); 7.4691 (2.6); 7.3587
(2.6); 7.0405 (1.3); 7.0202 (1.2); 4.2688 (0.6); 4.2533 (0.6); 4.2335 (1.4); 4.2176 (1.4); 4.1981 (0.7);
4.1822 (0.7); 3.4810 (0.5); 3.4588 (0.8); 3.4369 (0.7); 3.3231 (377.2); 2.7115 (0.4); 2.6804 (0.6);
2.6759 (1.2); 2.6714 (1.7); 2.6668 (1.2); 2.6623 (0.6); 2.5993 (0.4); 2.5794 (16.0); 2.5415 (104.8);
2.5248 (5.2); 2.5199 (7.6); 2.5114 (103.4); 2.5069 (205.2); 2.5024 (267.4); 2.4978 (193.5); 2.4933
(94.2); 2.3681 (0.4); 2.3382 (0.6); 2.3338 (1.2); 2.3292 (1.7); 2.3247 (1.2); 2.3202 (0.6); 2.2952 (0.4);
2.2643 (0.4); 2.2568 (0.4); 2.2453 (1.0); 2.2380 (1.3); 2.2301 (1.0); 2.2185 (1.6); 2.2110 (1.0); 2.1996
(0.5); 2.0123 (0.6); 2.0078 (0.8); 2.0020 (0.6); 1.9825 (1.6); 1.9719 (1.8); 1.9630 (2.0); 1.9554 (1.6);
1.9410 (0.3); 1.9337 (0.6); 1.9255 (0.4); 1.7921 (0.4); 1.7762 (1.0); 1.7627 (0.5); 1.7592 (0.5); 1.7498
(0.4); −0.0003 (3.0)
I-029: ¹H-NMR(300.2 MHz, CDCl3):
δ = 7.3638 (3.1); 7.3569 (3.1); 7.3491 (1.6); 7.3225 (2.8); 7.2983 (9.6); 7.2181 (2.3); 7.1907 (2.9);
7.0295 (2.3); 7.0223 (3.1); 7.0022 (2.0); 6.9952 (2.8); 6.9391 (1.4); 6.9339 (1.6); 6.9119 (1.3); 6.9071
(1.4); 6.8625 (2.2); 6.8571 (2.7); 6.2724 (1.2); 6.2521 (0.7); 3.8363 (1.2); 3.8148 (3.2); 3.7933 (3.2);
3.7718 (1.2); 3.0968 (2.3); 3.0747 (4.2); 3.0525 (2.0); 2.4151 (16.0); 2.3069 (0.4); 1.9783 (0.3);
1.9610 (0.7); 1.9499 (0.8); 1.9335 (1.3); 1.9167 (0.8); 1.9059 (0.8); 1.8894 (0.4); 1.5964 (7.1); 1.3044
(1.3); 1.0457 (0.9); 1.0301 (2.4); 1.0237 (2.6); 1.0084 (1.7); 1.0019 (2.6); 0.9959 (2.3); 0.9809 (1.1);
0.9412 (0.5); 0.9197 (1.1); 0.8969 (0.5); 0.7565 (1.1); 0.7410 (3.2); 0.7360 (2.9); 0.7248 (2.8); 0.7194
(3.0); 0.7030 (0.8); 0.1075 (0.8); 0.0376 (8.2)
I-030: ¹H-NMR(300.2 MHz, CDCl3):
δ = 8.3152 (10.5); 7.9723 (1.1); 7.6904 (4.2); 7.6729 (5.9); 7.5352 (3.2); 7.5273 (4.0); 7.4980 (6.7);
7.4751 (1.2); 7.4660 (1.2); 7.4597 (1.9); 7.4527 (2.5); 7.4450 (7.4); 7.4167 (3.0); 7.3046 (36.3);
5.3440 (1.2); 4.2784 (1.7); 4.2582 (1.7); 4.2306 (3.7); 4.2104 (3.6); 4.2005 (0.8); 4.1827 (1.9); 4.1768
(2.0); 4.1626 (1.8); 4.1530 (1.9); 4.1292 (0.8); 4.1079 (0.6); 2.0895 (9.9); 2.0521 (0.7); 1.6060 (16.0);
1.3266 (2.3); 1.3028 (4.8); 1.2790 (2.2); 1.0031 (0.4); 0.9785 (0.9); 0.9540 (0.4); 0.1123 (1.9); 0.0533
(1.0); 0.0426 (31.1); 0.0317 (1.1)
I-031: ¹H-NMR(400.0 MHz, d₆-DMSO):
δ = 9.3389 (0.5); 9.2040 (0.9); 8.1063 (1.6); 7.9541 (2.4); 7.8653 (2.1); 7.7723 (0.9); 7.6898 (0.6);
7.6707 (1.1); 7.6339 (0.6); 7.6142 (0.3); 7.6003 (0.5); 4.6871 (1.1); 4.6728 (1.1); 3.3281 (12.0);
2.8936 (16.0); 2.7348 (14.0); 2.6160 (5.5); 2.5134 (4.8); 2.5090 (10.0); 2.5046 (13.3); 2.5000 (9.5);
2.4957 (4.6); −0.0002 (2.2)
I-032: ¹H-NMR(300.2 MHz, CDCl3):
δ = 8.9417 (4.5); 8.8312 (4.0); 8.8227 (4.1); 8.3484 (14.0); 7.9412 (2.6); 7.9347 (4.2); 7.9283 (2.6);
7.8152 (1.5); 7.4743 (4.2); 7.4619 (3.6); 7.4568 (4.9); 7.4507 (4.7); 7.4467 (6.3); 7.3268 (3.9); 7.3204
(3.6); 7.2998 (42.8); 7.2936 (3.7); 6.1401 (1.1); 6.1299 (1.1); 6.1146 (1.2); 6.1043 (1.1); 5.9835 (1.1);
5.9734 (1.2); 5.9586 (1.2); 5.9479 (1.1); 5.3388 (0.4); 4.3915 (0.7); 4.3812 (0.8); 4.3686 (0.6); 4.3579
(0.7); 4.3426 (0.8); 4.3324 (0.9); 4.3194 (0.8); 4.3091 (0.8); 4.2959 (0.6); 4.2856 (0.7); 4.2728 (0.7);
4.2625 (0.7); 4.2472 (0.8); 4.2367 (0.8); 4.2240 (0.9); 4.2136 (0.8); 4.1958 (0.6); 4.1719 (1.5); 4.1481
(1.5); 4.1245 (0.8); 4.1034 (0.5); 3.8755 (0.9); 3.8590 (0.9); 3.8504 (0.8); 3.8335 (0.8); 3.8268 (0.7);
3.8100 (1.4); 3.8013 (0.8); 3.7932 (1.0); 3.7847 (1.4); 3.7678 (0.8); 3.7611 (0.8); 3.7447 (0.7); 3.7353
(0.6); 3.7190 (0.6); 2.0835 (8.4); 1.5900 (16.0); 1.3218 (2.1); 1.2979 (5.2); 1.2742 (2.1); 0.9985 (0.4);
0.9741 (0.9); 0.9498 (0.4); 0.0494 (1.3); 0.0386 (41.6); 0.0278 (1.9)
I-033: ¹H-NMR(300.2 MHz, CDCl3):
δ = 8.3143 (2.0); 7.6810 (0.8); 7.6636 (1.4); 7.6449 (0.4); 7.6169 (1.0); 7.5904 (7.6); 7.5814 (6.7);
7.5731 (15.0); 7.5700 (16.0); 7.5368 (0.8); 7.4966 (7.7); 7.4849 (8.6); 7.4566 (12.2); 7.4471 (7.8);
7.4414 (12.0); 7.4368 (9.4); 7.4284 (5.8); 7.4216 (4.3); 7.4110 (3.0); 7.4026 (2.1); 7.3675 (0.6);
7.3606 (0.6); 7.2988 (20.5); 7.2853 (6.5); 7.2786 (6.2); 7.2575 (4.9); 7.2507 (4.9); 7.2357 (0.5);
6.5053 (1.9); 6.4844 (2.9); 6.4660 (1.9); 6.1322 (2.0); 6.1228 (2.3); 6.1070 (2.2); 6.0978 (2.1); 5.9762
(2.0); 5.9668 (2.2); 5.9510 (2.2); 5.9418 (2.0); 5.3365 (0.8); 4.4254 (0.3); 4.3617 (1.0); 4.3523 (1.1);
4.3382 (1.1); 4.3286 (1.1); 4.3127 (1.2); 4.3032 (1.3); 4.2891 (1.2); 4.2795 (1.3); 4.2648 (1.2); 4.2553
(1.1); 4.2412 (1.2); 4.2315 (1.1); 4.2159 (1.5); 4.2062 (1.3); 4.1923 (1.4); 4.1826 (1.3); 3.8415 (1.3);
3.8243 (1.6); 3.8163 (1.4); 3.7989 (1.4); 3.7926 (1.2); 3.7733 (1.9); 3.7675 (1.4); 3.7551 (1.7); 3.7491
(1.9); 3.7342 (1.7); 3.7301 (1.4); 3.7235 (1.2); 3.7062 (1.1); 3.6983 (1.0); 3.6810 (1.0); 3.1304 (0.5);
1.6209 (11.5); 1.4378 (0.5); 1.3350 (0.5); 1.2913 (4.6); 0.9392 (0.4); 0.9178 (1.0); 0.8931 (0.6);
0.1076 (3.6); 0.0470 (0.5); 0.0362 (18.4); 0.0254 (0.8)
I-034: ¹H-NMR(400.0 MHz, d₆-DMSO):
δ = 9.0740 (2.0); 7.9542 (0.8); 7.7629 (5.4); 7.7516 (2.4); 7.7231 (1.4); 7.7033 (1.1); 7.6646 (1.4);
7.6411 (1.6); 7.6356 (1.8); 7.5897 (1.0); 7.5643 (1.0); 7.5435 (1.8); 7.5375 (1.8); 7.5259 (0.4); 7.5169
(1.2); 7.4973 (0.4); 3.3567 (14.3); 3.3505 (18.1); 3.3486 (17.9); 3.3446 (17.9); 2.8913 (5.6); 2.7330
(5.1); 2.6098 (11.5); 2.5133 (5.8); 2.5090 (12.2); 2.5045 (16.3); 2.5000 (11.7); 2.4955 (5.7); 1.6740
(16.0); −0.0002 (0.5)
I-035: ¹H-NMR(400.2 MHz, d₆-DMSO):
δ = 9.0689 (0.6); 9.0535 (1.4); 9.0379 (0.7); 8.3101 (0.8); 7.7355 (0.6); 7.7158 (1.8); 7.6960 (1.5);
7.6676 (1.9); 7.6575 (6.4); 7.6484 (1.0); 7.5862 (2.2); 7.5315 (1.2); 7.5109 (1.0); 7.4811 (2.4); 7.4607
(2.6); 7.3975 (2.7); 7.0775 (1.4); 7.0596 (1.2); 7.0569 (1.2); 4.2676 (0.6); 4.2523 (0.6); 4.2326 (1.4);
4.2169 (1.4); 4.1973 (0.7); 4.1813 (0.7); 3.3237 (218.0); 2.9392 (0.5); 2.9338 (0.5); 2.9147 (1.0);
2.8955 (0.6); 2.8906 (0.6); 2.6803 (0.3); 2.6759 (0.7); 2.6714 (1.0); 2.6669 (0.7); 2.6623 (0.4); 2.5797
(16.0); 2.5417 (84.6); 2.5248 (3.0); 2.5200 (4.6); 2.5114 (60.0); 2.5069 (120.0); 2.5024 (158.2);
2.4978 (116.8); 2.4934 (58.3); 2.3680 (0.4); 2.3381 (0.4); 2.3338 (0.8); 2.3292 (1.0); 2.3246 (0.8);
2.3205 (0.4); 1.9799 (0.4); 1.9752 (0.4); 1.9614 (0.8); 1.9513 (0.9); 1.9478 (0.9); 1.9360 (1.0); 1.9328
(1.0); 1.9260 (0.9); 1.9125 (0.5); 1.9067 (0.5); 1.7438 (0.7); 1.7342 (1.1); 1.7227 (1.5); 1.7136 (1.0);
1.7067 (0.9); 1.6907 (0.5); 1.6816 (0.4); 1.6578 (0.4); 1.6512 (0.4); 1.6382 (0.6); 1.6300 (0.9); 1.6182
(1.2); 1.6107 (1.3); 1.5984 (1.3); 1.5919 (0.6); 1.5883 (0.6); 1.5832 (0.4); 1.4498 (0.4); 1.4302 (0.8);
1.4211 (0.8); 1.4136 (0.7); 1.4058 (1.0); 1.4003 (0.9); 1.3914 (0.7); 1.3850 (0.6); 1.3805 (0.6); 1.3756
(0.7); 0.2083 (0.4); −0.0002 (1.6)
I-036: ¹H-NMR(400.2 MHz, d₆-DMSO):
δ = 8.7437 (0.5); 8.7295 (1.0); 8.7156 (0.5); 8.0812 (6.9); 7.7605 (0.4); 7.7410 (1.3); 7.7208 (1.4);
7.7058 (1.7); 7.6937 (2.1); 7.6050 (1.1); 7.5851 (0.8); 7.1609 (2.9); 7.1395 (3.3); 6.7362 (0.4); 6.7289
(3.5); 6.7075 (3.2); 3.9028 (0.4); 3.6412 (16.0); 3.5171 (0.7); 3.5000 (1.8); 3.4851 (1.8); 3.4680 (0.8);
3.3261 (56.4); 2.7831 (1.3); 2.7657 (2.7); 2.7482 (1.2); 2.6754 (0.4); 2.6709 (0.6); 2.6663 (0.4);
2.5242 (2.0); 2.5106 (38.1); 2.5064 (76.0); 2.5020 (98.7); 2.4974 (71.9); 2.4932 (35.9); 2.3331 (0.4);
2.3288 (0.6); 2.3242 (0.4); −0.0002 (0.4)
I-037: ¹H-NMR(400.0 MHz, CD3CN):
δ = 8.4807 (4.0); 8.4688 (4.1); 8.2534 (1.5); 8.1058 (16.0); 8.0164 (0.8); 7.9419 (4.1); 7.9219 (4.4);
7.7029 (1.3); 7.6828 (4.9); 7.6650 (13.1); 7.6468 (1.3); 7.5737 (0.4); 7.4931 (6.8); 7.4724 (2.6);
7.4668 (4.2); 7.4618 (2.3); 7.4495 (3.1); 7.3192 (0.4); 7.2593 (2.8); 7.2469 (2.9); 7.2396 (2.9); 7.2273
(2.6); 7.0640 (0.4); 4.1542 (0.4); 4.1382 (0.4); 3.9479 (3.7); 3.9325 (10.4); 3.9170 (10.7); 3.9015
(4.0); 3.2741 (4.8); 3.2584 (8.8); 3.2427 (4.4); 2.4427 (1.0); 2.2297 (1.5); 2.1284 (29.5); 2.1136 (0.6);
2.1064 (0.6); 2.1004 (0.4); 1.9632 (2.5); 1.9570 (6.5); 1.9514 (33.7); 1.9453 (60.9); 1.9392 (81.9);
1.9330 (56.6); 1.9269 (29.5); 1.7736 (0.4); 1.7676 (0.5); 1.7613 (0.3); 1.2851 (0.4); 1.2700 (0.8);
0.1460 (0.9); 0.0077 (7.1); −0.0002 (174.4); −0.1492 (0.9)
I-038: ¹H-NMR(400.1 MHz, d₆-DMSO):
δ = 9.1500 (2.9); 8.3549 (16.0); 7.7930 (1.2); 7.7735 (4.1); 7.7540 (4.8); 7.7439 (5.5); 7.7241 (1.8);
7.7003 (5.9); 7.6260 (3.5); 7.6066 (2.7); 7.5867 (7.7); 7.5653 (9.9); 7.4181 (9.4); 7.3969 (7.6); 4.1915
(1.4); 4.1778 (1.5); 4.1570 (3.0); 4.1434 (3.0); 4.1223 (1.6); 4.1089 (1.5); 3.3024 (42.7); 2.5052
(14.7); 2.5008 (20.0); 2.4964 (15.0); 2.0719 (0.6); −0.0002 (7.2)
I-039: ¹H-NMR(300.2 MHz, CDCl3):
δ = 7.6217 (0.6); 7.5950 (4.6); 7.5912 (4.3); 7.5860 (3.8); 7.5778 (9.3); 7.5746 (9.7); 7.5255 (6.1);
7.4968 (9.2); 7.4476 (4.6); 7.4103 (0.9); 7.3899 (10.2); 7.3771 (3.4); 7.3619 (6.5); 7.2986 (17.0);
6.3031 (1.2); 6.2826 (2.3); 6.2623 (1.2); 4.2568 (2.5); 4.2360 (2.4); 4.2091 (5.3); 4.1883 (5.0); 4.1614
(2.7); 4.1406 (2.5); 2.8691 (6.3); 2.8631 (15.8); 2.8566 (16.0); 2.8503 (6.2); 1.6006 (12.4); 1.3191
(0.4); 1.2929 (2.2); 1.2654 (0.3); 0.9190 (0.6); 0.8952 (0.3); 0.1078 (4.0); 0.0478 (0.6); 0.0371 (15.7);
0.0261 (0.6)
I-040: ¹H-NMR(300.2 MHz, CDCl3):
δ = 8.1644 (0.5); 8.1445 (0.9); 8.1246 (0.5); 7.6145 (2.0); 7.5861 (2.5); 7.5689 (1.3); 7.5453 (3.9);
7.5146 (2.0); 7.5084 (2.1); 7.4867 (1.8); 7.4348 (0.8); 7.4270 (1.4); 7.4197 (0.8); 7.4135 (0.5); 7.4106
(0.5); 7.4045 (0.9); 7.3972 (0.6); 7.3145 (1.3); 7.3079 (1.2); 7.2986 (2.2); 7.2863 (1.1); 7.2797 (1.0);
5.3317 (0.8); 4.4173 (0.9); 4.3967 (0.8); 4.3674 (1.9); 4.3468 (1.8); 4.3175 (1.0); 4.2970 (0.9); 4.1197
(0.7); 3.8547 (1.6); 3.8362 (2.9); 3.8170 (1.8); 3.4061 (16.0); 3.3505 (0.5); 3.1150 (1.8); 3.0959 (2.8);
3.0773 (1.6); 2.2005 (0.9); 1.2910 (0.5); 0.0342 (1.6)
I-041: ¹H-NMR(300.2 MHz, CDCl3):
δ = 7.5857 (0.6); 7.5565 (4.0); 7.5357 (5.9); 7.5279 (5.1); 7.4596 (2.3); 7.4268 (4.3); 7.3995 (3.9);
7.3780 (1.1); 7.2988 (16.8); 6.3858 (0.5); 6.3659 (0.9); 6.3463 (0.5); 5.3371 (10.2); 4.2732 (1.1);
4.2521 (1.1); 4.2253 (2.3); 4.2041 (2.2); 4.1773 (1.3); 4.1673 (0.4); 4.1561 (1.2); 4.1433 (0.3); 3.7328
(0.4); 3.7204 (0.4); 3.7081 (0.3); 3.6979 (0.4); 3.6925 (0.4); 2.6852 (16.0); 2.6552 (1.0); 2.6299 (3.0);
2.6046 (3.1); 2.5796 (1.0); 2.2052 (0.9); 2.0798 (0.9); 1.6100 (4.7); 1.3375 (0.4); 1.3190 (0.7); 1.2931
(4.2); 1.2713 (0.9); 1.2555 (3.8); 1.2305 (7.8); 1.2052 (3.6); 1.1809 (0.4); 0.9176 (0.6); 0.8934 (0.5);
0.8676 (0.4); 0.1073 (6.9); 0.0950 (0.3); 0.0481 (0.4); 0.0373 (11.5); 0.0265 (0.5)
I-042: ¹H-NMR(300.2 MHz, CDCl3):
δ = 8.9406 (4.7); 8.8296 (4.3); 8.8211 (4.4); 8.3176 (16.0); 7.9490 (2.8); 7.9426 (4.5); 7.9361 (2.7);
7.8142 (1.0); 7.7948 (1.7); 7.7768 (1.0); 7.6043 (5.1); 7.5759 (6.3); 7.5401 (4.4); 7.5338 (4.5); 7.3595
(3.2); 7.3528 (3.0); 7.3312 (2.6); 7.3246 (2.5); 7.2995 (26.4); 5.3379 (0.7); 4.4987 (2.6); 4.4783 (2.5);
4.4494 (5.5); 4.4289 (5.3); 4.4000 (2.8); 4.3796 (2.7); 4.1941 (0.3); 4.1703 (1.0); 4.1464 (1.0); 4.1229
(0.4); 2.0821 (4.8); 2.0442 (0.9); 1.5965 (13.8); 1.3207 (1.3); 1.2968 (3.0); 1.2731 (1.2); 0.0488 (0.8);
0.0378 (25.6); 0.0268 (0.9)
I-043: ¹H-NMR(300.2 MHz, CDCl3):
δ = 9.4794 (2.2); 9.0627 (6.0); 8.1365 (0.8); 8.1196 (1.5); 8.1008 (0.9); 7.6262 (0.5); 7.5999 (2.8);
7.5805 (7.6); 7.5774 (6.7); 7.5653 (0.7); 7.5606 (0.6); 7.4185 (3.7); 7.3941 (1.5); 7.3835 (2.2); 7.3763
(1.7); 7.3719 (1.1); 7.3633 (1.6); 7.3559 (1.0); 7.3297 (3.5); 7.2987 (10.6); 7.0402 (3.9); 6.9391 (2.1);
6.9125 (1.9); 4.2072 (1.9); 4.1877 (1.9); 4.1711 (0.4); 4.1595 (4.1); 4.1399 (4.0); 4.1117 (2.1); 4.0922
(2.0); 2.7019 (0.3); 2.6896 (0.7); 2.6790 (1.0); 2.6671 (1.5); 2.6599 (1.5); 2.6478 (1.1); 2.6376 (0.7);
2.6255 (0.3); 2.4905 (6.4); 2.4838 (11.6); 2.4765 (6.6); 2.3006 (16.0); 2.0831 (0.9); 1.6302 (2.5);
1.3209 (0.6); 1.2948 (3.1); 1.2734 (0.6); 1.0201 (1.0); 0.9969 (4.2); 0.9796 (4.4); 0.9741 (3.4); 0.9569
(1.4); 0.9258 (0.4); 0.9189 (0.5); 0.9041 (0.4); 0.8935 (0.4); 0.7484 (1.4); 0.7318 (3.5); 0.7250 (4.0);
0.7196 (3.6); 0.7141 (3.3); 0.6963 (1.0); 0.0489 (0.4); 0.0382 (9.3); 0.0273 (0.3)
I-044: ¹H-NMR(400.0 MHz, d₆-DMSO):
δ = 8.8277 (1.7); 7.9522 (0.4); 7.7599 (3.9); 7.7430 (0.5); 7.7236 (1.2); 7.7039 (0.9); 7.6571 (3.4);
7.6376 (0.8); 7.5972 (1.1); 7.5780 (0.7); 7.3279 (2.6); 7.3075 (3.2); 7.0599 (2.7); 7.0398 (2.3); 3.3821
(17.7); 3.3732 (15.6); 3.3681 (17.4); 3.3562 (18.9); 2.8906 (2.6); 2.7322 (2.3); 2.6121 (11.7); 2.5217
(0.4); 2.5131 (6.0); 2.5087 (12.7); 2.5042 (17.1); 2.4996 (12.2); 2.4951 (5.9); 2.2440 (9.0); 1.6126
(16.0); −0.0002 (0.4)
I-045: ¹H-NMR(499.9 MHz, CDCl3):
δ = 7.5397 (0.6); 7.5242 (1.6); 7.5086 (1.8); 7.4990 (2.0); 7.4831 (0.8); 7.4660 (2.0); 7.4346 (2.2);
7.4179 (2.6); 7.4044 (2.0); 7.4010 (2.9); 7.3986 (2.6); 7.3811 (0.9); 7.2614 (7.1); 7.2287 (1.6); 7.2246
(1.4); 7.2119 (1.3); 7.2079 (1.2); 6.3927 (0.6); 6.3807 (0.9); 6.3687 (0.5); 6.0186 (0.5); 6.0126 (0.6);
6.0039 (0.6); 5.9979 (0.5); 5.9250 (0.5); 5.9190 (0.6); 5.9103 (0.6); 5.9043 (0.5); 4.2254 (0.3); 4.2179
(0.3); 4.2118 (0.3); 4.2021 (0.4); 4.1960 (0.4); 4.1885 (0.4); 4.1823 (0.4); 4.1756 (0.3); 4.1619 (0.3);
4.1461 (0.4); 4.1399 (0.4); 4.1325 (0.4); 3.8462 (0.4); 3.8350 (0.4); 3.8316 (0.4); 3.8203 (0.4); 3.8169
(0.4); 3.8044 (0.6); 3.7924 (0.6); 3.7908 (0.6); 3.7782 (0.4); 3.7748 (0.3); 3.7635 (0.3); 2.7056 (0.5);
2.6943 (0.7); 2.6906 (0.8); 2.6793 (1.8); 2.6666 (2.7); 2.6594 (16.0); 2.6521 (1.8); 2.6401 (0.5);
2.6373 (0.5); 2.0773 (0.4); 2.0010 (10.0); 1.5767 (2.0); 1.2572 (3.5); 1.2421 (7.0); 1.2269 (3.0);
0.0061 (0.4); −0.0002 (6.3)
I-046: ¹H-NMR(400.2 MHz, d₆-DMSO):
δ = 9.0811 (0.6); 9.0655 (1.4); 9.0497 (0.6); 8.3100 (0.7); 7.7379 (0.6); 7.7183 (1.7); 7.6985 (1.5);
7.6694 (1.8); 7.6579 (6.4); 7.6502 (1.1); 7.5979 (2.1); 7.5329 (1.2); 7.5143 (3.3); 7.4939 (2.6); 7.4566
(2.6); 7.1344 (1.3); 7.1312 (1.3); 7.1142 (1.2); 7.1108 (1.2); 4.2726 (0.6); 4.2569 (0.6); 4.2372 (1.4);
4.2214 (1.3); 4.2015 (0.7); 4.1854 (0.6); 3.9603 (1.4); 3.9417 (1.9); 3.9216 (1.7); 3.9129 (0.7); 3.9036
(1.5); 3.8920 (1.5); 3.8828 (0.9); 3.8712 (0.8); 3.7844 (0.9); 3.7654 (2.2); 3.7450 (1.8); 3.7258 (0.7);
3.4830 (1.5); 3.4652 (2.1); 3.4625 (1.6); 3.4445 (1.8); 3.3809 (0.4); 3.3621 (1.2); 3.3426 (2.1); 3.3238
(181.8); 2.7118 (0.4); 2.6808 (0.3); 2.6761 (0.7); 2.6716 (0.9); 2.6670 (0.7); 2.6624 (0.3); 2.5822
(16.0); 2.5417 (94.9); 2.5250 (2.8); 2.5202 (4.2); 2.5116 (54.2); 2.5071 (107.5); 2.5025 (140.3);
2.4980 (101.6); 2.4935 (49.2); 2.3682 (0.4); 2.3339 (0.6); 2.3293 (0.9); 2.3248 (0.6); 2.2921 (0.4);
2.2805 (0.4); 2.2729 (0.6); 2.2612 (0.9); 2.2525 (0.5); 2.2499 (0.5); 2.2414 (0.9); 2.2302 (0.6); 2.2220
(0.4); 2.2104 (0.4); 1.8433 (0.4); 1.8239 (1.0); 1.8124 (0.4); 1.8037 (1.0); 1.7932 (0.9); 1.7842 (0.4);
1.7730 (0.8); 1.7535 (0.3); −0.0002 (1.6)
I-047: ¹H-NMR(300.2 MHz, CDCl3):
δ = 7.5817 (2.3); 7.4052 (0.6); 7.3774 (3.9); 7.3704 (2.9); 7.3650 (2.4); 7.3425 (0.4); 7.3369 (0.4);
7.2983 (10.9); 7.1501 (0.5); 7.1451 (0.4); 7.1345 (0.3); 7.1228 (1.8); 7.1142 (1.3); 7.1019 (3.6);
7.0930 (1.3); 7.0859 (1.4); 7.0660 (0.4); 6.8681 (0.6); 6.8556 (0.7); 6.8466 (1.0); 6.8375 (1.0); 6.8212
(0.6); 6.8141 (0.6); 6.5223 (0.4); 6.5039 (0.8); 6.4828 (0.4); 6.0902 (0.5); 6.0794 (0.6); 6.0687 (0.6);
6.0579 (0.5); 5.9357 (0.5); 5.9250 (0.5); 5.9144 (0.6); 5.9037 (0.5); 4.2173 (0.4); 4.2061 (0.4); 4.1954
(0.4); 4.1841 (0.5); 4.1339 (0.4); 4.1229 (0.4); 4.1123 (0.4); 4.0262 (0.3); 4.0056 (0.6); 3.9847 (0.4);
3.9565 (0.4); 3.9482 (0.4); 3.9280 (0.6); 3.9069 (0.4); 3.8787 (0.4); 3.8576 (0.4); 2.4597 (1.6); 2.4459
(16.0); 2.1560 (0.4); 2.1386 (0.5); 2.1274 (0.5); 2.1103 (0.9); 2.0928 (0.6); 2.0819 (0.6); 2.0423 (1.4);
1.5977 (3.1); 1.0814 (0.7); 1.0661 (1.9); 1.0592 (2.0); 1.0444 (1.1); 1.0375 (2.0); 1.0310 (1.8); 1.0163
(0.9); 0.8243 (0.9); 0.8092 (2.3); 0.8038 (2.1); 0.7923 (2.0); 0.7869 (2.4); 0.7703 (0.7); 0.1073 (0.8);
0.0481 (0.4); 0.0374 (10.8); 0.0265 (0.4)
I-048: ¹H-NMR(400.2 MHz, d₆-DMSO):
δ = 9.0374 (1.5); 9.0160 (1.5); 7.8268 (6.6); 7.7205 (0.6); 7.7005 (1.6); 7.6813 (1.4); 7.6427 (1.9);
7.6238 (3.5); 7.5812 (1.4); 7.5591 (1.1); 7.3366 (3.0); 7.2483 (7.6); 5.1457 (0.8); 5.1292 (0.8); 5.1111
(0.3); 4.0555 (0.4); 4.0377 (1.1); 4.0199 (1.2); 4.0022 (0.4); 3.3230 (16.5); 2.7648 (0.6); 2.7502 (1.5);
2.7391 (1.6); 2.6702 (0.4); 2.6063 (16.0); 2.5234 (1.0); 2.5100 (22.6); 2.5057 (45.1); 2.5013 (58.8);
2.4969 (42.4); 2.4926 (20.8); 2.3282 (0.3); 2.0150 (0.4); 1.9888 (5.5); 1.9714 (0.6); 1.9563 (0.5);
1.8850 (0.4); 1.8655 (0.5); 1.8588 (0.6); 1.8398 (0.5); 1.7950 (0.3); 1.7716 (1.0); 1.7531 (1.3); 1.7305
(1.0); 1.3970 (0.6); 1.1922 (1.3); 1.1744 (2.5); 1.1567 (1.2); −0.0002 (0.9)
I-049: ¹H-NMR(400.2 MHz, d₆-DMSO):
δ = 11.7200 (2.0); 7.9527 (1.0); 7.8648 (1.0); 7.8288 (5.6); 7.7341 (0.7); 7.7144 (2.1); 7.6946 (1.7);
7.6632 (2.2); 7.6435 (1.2); 7.6076 (0.6); 7.5901 (2.4); 7.5506 (1.4); 7.5313 (1.0); 7.3642 (0.3); 7.1997
(2.3); 7.1806 (2.6); 7.1583 (0.4); 7.1273 (0.3); 7.1091 (0.3); 7.0279 (0.9); 7.0122 (2.9); 6.8897 (1.5);
6.8706 (1.3); 5.0383 (1.5); 4.9271 (7.7); 4.6788 (0.5); 3.3333 (30.3); 2.8917 (6.8); 2.7333 (6.0);
2.6104 (3.2); 2.5986 (16.0); 2.5367 (0.5); 2.5262 (1.7); 2.5120 (13.1); 2.5077 (25.7); 2.5033 (33.3);
2.4987 (24.2); 2.4944 (11.9); 2.4291 (4.6); 2.3808 (12.3); 2.2717 (0.9); 2.2271 (12.0); 2.0020 (0.4);
1.8525 (0.8); 1.2403 (1.2); −0.0002 (1.0)
I-050: ¹H-NMR(300.2 MHz, d₆-DMSO):
δ = 9.0846 (0.4); 9.0652 (0.8); 9.0457 (0.4); 7.7138 (0.9); 7.6877 (0.8); 7.6604 (1.0); 7.6346 (0.4);
7.5464 (1.2); 7.5198 (0.7); 7.4859 (1.3); 7.4566 (2.4); 7.4214 (2.7); 7.3931 (1.1); 5.8316 (0.3); 5.7784
(0.4); 5.6747 (0.3); 3.8795 (0.4); 3.8585 (0.4); 3.8330 (0.4); 3.8107 (0.4); 3.7899 (0.4); 3.3498 (16.0);
2.7092 (1.0); 2.5528 (7.2); 2.5341 (1.5); 2.5281 (3.1); 2.5220 (4.2); 2.5159 (3.0); 2.5100 (1.4); 2.1706
(7.0); 0.0199 (3.3)
I-051: ¹H-NMR(499.9 MHz, d₆-DMSO):
δ = 9.3477 (2.7); 9.3354 (5.3); 9.3230 (2.6); 8.3085 (3.3); 8.2927 (6.4); 8.2769 (3.7); 8.0907 (16.0);
7.8894 (7.7); 7.8743 (8.0); 7.8573 (9.2); 7.8380 (0.4); 7.7034 (0.9); 7.6865 (0.9); 7.5981 (6.9); 7.5816
(6.6); 7.5517 (1.4); 7.5348 (1.1); 7.4994 (5.6); 7.4824 (9.1); 7.4347 (6.3); 7.4179 (3.8); 4.2091 (2.4);
4.1966 (2.7); 4.1815 (5.2); 4.1690 (5.0); 4.1538 (2.8); 4.1413 (2.4); 3.3379 (7.9); 3.3129 (1.0); 3.2827
(1.9); 3.2526 (1.0); 2.5092 (3.2); −0.0002 (1.1)
I-052: ¹H-NMR(300.2 MHz, CDCl3):
δ = 8.1324 (0.8); 8.1121 (1.5); 8.0925 (0.8); 7.6143 (0.8); 7.5884 (2.6); 7.5636 (6.4); 7.5573 (3.4);
7.5456 (13.2); 7.4917 (4.2); 7.4624 (9.4); 7.4546 (4.5); 7.4025 (8.6); 7.3749 (5.2); 7.2983 (20.7);
5.3369 (16.0); 4.2546 (2.0); 4.2343 (1.9); 4.2078 (4.3); 4.1875 (4.1); 4.1611 (2.1); 4.1408 (2.1);
3.5918 (3.8); 3.5695 (10.4); 3.5475 (4.0); 2.1254 (0.4); 2.1054 (4.3); 2.0933 (4.4); 2.0832 (11.8);
2.0729 (4.4); 2.0609 (4.0); 2.0415 (0.4); 1.5990 (6.5); 1.2921 (0.8); 0.1067 (0.7); 0.0472 (0.7); 0.0365
(21.0); 0.0256 (0.7)
I-053: ¹H-NMR(499.9 MHz, CDCl3):
δ = 7.5319 (0.5); 7.5165 (1.7); 7.5008 (1.9); 7.4913 (2.2); 7.4751 (0.9); 7.4645 (2.2); 7.4060 (1.4);
7.3907 (1.0); 7.3685 (2.2); 7.3527 (2.4); 7.2606 (7.2); 7.1939 (2.6); 7.0498 (1.5); 7.0343 (1.3); 6.3172
(0.6); 6.3058 (1.0); 6.2939 (0.6); 6.0331 (0.5); 6.0268 (0.6); 6.0183 (0.6); 6.0120 (0.5); 5.9393 (0.5);
5.9330 (0.6); 5.9244 (0.6); 5.9182 (0.5); 5.2979 (4.4); 4.2170 (0.4); 4.2106 (0.4); 4.2032 (0.4); 4.1967
(0.4); 4.1907 (0.3); 4.1843 (0.3); 4.1768 (0.3); 4.1615 (0.4); 4.1550 (0.4); 4.1476 (0.4); 4.1411 (0.3);
3.8423 (0.3); 3.8317 (0.4); 3.8276 (0.4); 3.8167 (0.4); 3.8135 (0.4); 3.8019 (0.7); 3.7906 (0.5); 3.7873
(0.6); 3.7761 (0.4); 3.7726 (0.3); 3.7617 (0.3); 2.7104 (0.6); 2.7063 (0.7); 2.6953 (1.8); 2.6909 (1.8);
2.6801 (1.9); 2.6759 (1.9); 2.6617 (16.0); 2.3065 (11.3); 1.5703 (5.2); 1.2613 (3.4); 1.2462 (7.1);
1.2390 (0.7); 1.2310 (3.2); −0.0002 (6.5)
I-054: ¹H-NMR(300.2 MHz, CDCl3):
δ = 8.3029 (16.0); 7.9498 (1.9); 7.7222 (0.6); 7.6937 (6.2); 7.6796 (14.0); 7.6496 (0.5); 7.5446 (4.6);
7.5172 (2.7); 7.4890 (9.6); 7.4796 (2.4); 7.4704 (7.4); 7.4652 (7.4); 7.4502 (2.0); 7.4418 (2.6); 7.3039
(56.4); 5.3437 (0.4); 4.4985 (2.6); 4.4779 (2.5); 4.4500 (5.5); 4.4295 (5.3); 4.4015 (2.7); 4.3810 (2.6);
1.5974 (44.8); 1.2977 (0.7); 0.1119 (3.9); 0.0530 (2.0); 0.0423 (51.4); 0.0312 (1.6)
I-055: ¹H-NMR(300.2 MHz, d₆-DMSO):
δ = 9.7835 (2.6); 9.2088 (1.2); 9.1882 (2.4); 9.1681 (1.2); 8.0017 (0.4); 7.9483 (13.7); 7.3533 (3.7);
7.3267 (4.3); 7.2937 (2.1); 7.2843 (0.7); 7.2653 (3.8); 7.2431 (1.2); 7.2375 (2.2); 7.1133 (4.4); 7.0084
(2.4); 6.9821 (2.2); 6.7366 (2.4); 6.7321 (2.5); 6.7124 (1.9); 6.7079 (2.3); 6.7021 (2.0); 6.6529 (2.1);
6.6486 (3.2); 6.6360 (3.4); 6.6286 (7.5); 6.6231 (6.8); 6.2130 (0.5); 5.7860 (1.4); 4.1426 (1.2); 4.1219
(1.2); 4.0932 (2.6); 4.0727 (2.5); 4.0435 (1.4); 4.0230 (1.3); 3.3582 (17.6); 2.5341 (6.5); 2.5281 (8.5);
2.5222 (6.2); 2.4780 (0.4); 2.4420 (11.9); 2.2722 (16.0); 0.0367 (0.5); 0.0259 (9.9); 0.0151 (0.4)
I-056: ¹H-NMR(300.2 MHz, CDCl3):
δ = 7.6142 (0.4); 7.5880 (2.0); 7.5684 (5.4); 7.5652 (5.1); 7.5518 (0.4); 7.5482 (0.4); 7.4708 (2.4);
7.4500 (0.4); 7.4338 (1.1); 7.4237 (1.6); 7.4164 (1.3); 7.4030 (1.1); 7.3953 (0.6); 7.2974 (14.1);
7.0527 (2.2); 7.0271 (3.1); 7.0021 (2.7); 6.9123 (1.6); 6.8864 (1.1); 6.7641 (1.7); 6.7249 (2.0); 6.7050
(2.2); 6.6658 (2.3); 6.1252 (3.8); 6.0662 (3.1); 6.0154 (0.6); 5.9968 (1.1); 5.9764 (0.6); 5.8682 (3.6);
5.8289 (3.3); 3.7732 (1.4); 3.7505 (3.6); 3.7299 (3.6); 3.7075 (1.5); 3.1760 (0.6); 2.9577 (0.6); 2.9483
(2.2); 2.9256 (4.4); 2.9027 (2.0); 2.3681 (0.6); 2.3187 (16.0); 2.2947 (14.2); 2.2091 (0.6); 1.6312
(0.6); 1.6097 (8.2); 1.2907 (0.9); 0.1065 (1.3); 0.0469 (0.4); 0.0361 (11.3); 0.0252 (0.4)
I-057: ¹H-NMR(400.1 MHz, d₆-DMSO):
δ = 9.1130 (1.6); 9.0985 (3.4); 9.0840 (1.8); 8.3767 (14.9); 7.7947 (1.2); 7.7756 (3.9); 7.7435 (16.0);
7.7247 (2.6); 7.6585 (3.7); 7.6393 (2.6); 7.5052 (1.7); 7.4842 (10.9); 7.4792 (8.3); 7.4752 (7.2);
7.4580 (1.4); 7.4542 (1.5); 6.0746 (1.2); 6.0613 (2.1); 6.0496 (1.3); 5.9593 (1.2); 5.9462 (2.3); 5.9343
(1.3); 3.9315 (1.8); 3.9166 (2.8); 3.9085 (1.7); 3.9013 (1.5); 3.8740 (2.2); 3.8596 (3.2); 3.8485 (1.6);
3.3018 (54.6); 2.5049 (18.0); 2.5007 (24.5); 2.4964 (18.7); 2.0718 (1.4); −0.0002 (8.8)
I-058: ¹H-NMR(400.1 MHz, d₆-DMSO):
δ = 9.1613 (9.7); 9.1495 (10.3); 9.0079 (2.0); 8.9935 (4.1); 8.9786 (2.2); 7.9613 (2.4); 7.8576 (10.1);
7.8458 (10.1); 7.7625 (1.7); 7.7432 (5.1); 7.7235 (4.8); 7.6993 (5.9); 7.6685 (7.4); 7.6267 (7.6);
7.5996 (4.3); 7.5793 (3.6); 7.5700 (7.7); 7.5489 (8.9); 7.3765 (4.8); 7.3713 (5.0); 7.3554 (4.2); 7.3503
(4.1); 6.0788 (1.4); 6.0664 (2.8); 6.0534 (1.6); 5.9636 (1.4); 5.9511 (2.8); 5.9382 (1.6); 3.9147 (1.9);
3.9029 (4.2); 3.8883 (2.8); 3.8618 (2.0); 3.8575 (2.0); 3.8468 (4.0); 3.8319 (2.6); 3.8086 (0.4); 3.3133
(170.5); 2.8991 (16.0); 2.7402 (14.3); 2.5136 (21.6); 2.5092 (29.9); 2.5049 (22.6)
I-059: ¹H-NMR(400.0 MHz, CD3CN):
δ = 7.9967 (1.3); 7.9566 (16.0); 7.9308 (6.6); 7.9104 (7.0); 7.7990 (1.8); 7.7357 (1.4); 7.7163 (4.4);
7.6967 (5.0); 7.6873 (6.1); 7.6675 (1.8); 7.5952 (0.5); 7.5707 (6.2); 7.5692 (6.1); 7.5288 (0.3); 7.5066
(3.6); 7.4871 (2.6); 7.2808 (6.2); 7.2604 (5.8); 5.4456 (1.1); 4.3717 (3.3); 4.3552 (3.3); 4.3387 (6.8);
4.3222 (6.7); 4.3058 (3.5); 4.2893 (3.4); 4.1591 (0.6); 4.1425 (0.6); 4.0677 (0.3); 4.0499 (0.3); 2.1295
(10.6); 1.9713 (1.6); 1.9635 (1.2); 1.9573 (3.2); 1.9516 (16.3); 1.9454 (29.4); 1.9393 (39.4); 1.9331
(27.1); 1.9269 (14.0); 1.2697 (0.4); 1.2214 (0.4); 1.2035 (0.8); 1.1858 (0.4); 0.1461 (0.4); 0.0079
(3.6); −0.0002 (89.3); −0.0073 (3.6); −0.0085 (3.7); −0.1494 (0.4)
I-060: ¹H-NMR(400.1 MHz, d₆-DMSO):
δ = 9.1650 (9.5); 9.1533 (9.8); 9.0205 (3.8); 8.9995 (3.9); 7.9612 (1.0); 7.9336 (9.9); 7.9219 (9.6);
7.7501 (1.5); 7.7305 (4.4); 7.7100 (4.0); 7.6756 (13.4); 7.6587 (3.1); 7.6240 (4.4); 7.6057 (2.9);
6.8916 (16.0); 5.0722 (1.0); 5.0546 (2.2); 5.0391 (2.2); 5.0208 (1.0); 3.3132 (157.4); 2.8991 (5.8);
2.7401 (5.2); 2.6641 (5.8); 2.6506 (3.4); 2.6221 (0.3); 2.5134 (20.8); 2.5090 (27.8); 2.5047 (20.4);
2.0378 (0.7); 2.0240 (1.4); 2.0180 (1.2); 2.0109 (1.7); 1.9932 (1.6); 1.9782 (2.2); 1.9674 (1.2); 1.9480
(1.3); 1.9422 (1.3); 1.9347 (1.6); 1.9291 (1.8); 1.9154 (1.4); 1.8559 (0.6); 1.8378 (1.2); 1.8211 (1.5);
1.8151 (1.4); 1.8044 (1.2); 1.7981 (1.1); 1.7871 (1.0); 1.7698 (0.6); 1.7474 (1.2); 1.7279 (1.8); 1.7223
(1.7); 1.7035 (1.6); 1.6975 (1.6); 1.6783 (0.7)
I-061: ¹H-NMR(400.0 MHz, d₆-DMSO):
δ = 9.1556 (1.8); 8.1659 (4.9); 7.9557 (0.4); 7.7859 (0.9); 7.7681 (1.5); 7.7600 (2.2); 7.7520 (1.8);
7.7308 (1.2); 7.7029 (2.0); 7.6961 (2.0); 7.6912 (1.7); 7.6440 (1.0); 7.6235 (0.7); 7.5667 (0.4); 7.5470
(1.9); 7.5422 (2.1); 7.5233 (1.2); 7.5041 (0.4); 3.3679 (14.5); 3.3616 (18.3); 3.3567 (17.9); 2.8932
(2.8); 2.7352 (2.5); 2.5159 (4.2); 2.5115 (8.9); 2.5070 (12.0); 2.5025 (8.6); 2.4981 (4.2); 1.6906 (16.0)
I-062: ¹H-NMR(300.2 MHz, CDCl3):
δ = 7.4540 (1.9); 7.4373 (1.7); 7.4265 (4.1); 7.3475 (1.2); 7.3212 (2.6); 7.2988 (10.6); 7.2283 (1.5);
7.2219 (1.4); 7.2003 (1.1); 7.1936 (1.2); 7.0151 (1.4); 6.9929 (1.9); 6.9899 (2.1); 6.9853 (2.2); 6.9663
(0.8); 6.9634 (0.8); 6.9584 (1.1); 6.9059 (1.6); 6.8995 (2.1); 6.8928 (1.2); 6.6096 (0.5); 6.5887 (0.8);
6.5686 (0.5); 6.0795 (0.4); 6.0689 (0.5); 6.0569 (0.5); 6.0465 (0.5); 5.9244 (0.5); 5.9140 (0.5); 5.9020
(0.5); 5.8916 (0.5); 4.1924 (0.4); 4.1819 (0.4); 4.1704 (0.4); 4.1599 (0.4); 4.1547 (0.3); 4.1055 (0.4);
4.0949 (0.3); 4.0836 (0.3); 4.0730 (0.3); 3.9551 (0.3); 3.9335 (0.5); 3.9129 (0.4); 3.8799 (0.4); 3.8599
(0.5); 3.8374 (0.4); 3.8105 (0.4); 2.4139 (16.0); 1.9615 (0.5); 1.9503 (0.6); 1.9335 (1.1); 1.9167 (0.6);
1.9056 (0.6); 1.8887 (0.3); 1.5969 (6.8); 1.3054 (1.7); 1.0399 (0.7); 1.0246 (1.8); 1.0179 (2.0); 1.0030
(1.2); 0.9963 (2.0); 0.9896 (1.8); 0.9751 (1.0); 0.9418 (0.6); 0.9203 (1.9); 0.8968 (0.7); 0.7582 (0.9);
0.7429 (2.3); 0.7368 (2.1); 0.7266 (2.0); 0.7207 (2.4); 0.7045 (0.8); 0.1080 (0.8); 0.0489 (0.4); 0.0382
(10.0); 0.0273 (0.4)
I-063: ¹H-NMR(300.2 MHz, CDCl3):
δ = 7.3849 (1.6); 7.3582 (1.8); 7.3298 (1.0); 7.3033 (2.7); 7.2987 (9.0); 7.2772 (1.4); 7.0892 (1.7);
7.0036 (2.1); 6.9819 (2.1); 6.9776 (2.9); 6.9588 (0.8); 6.9558 (0.7); 6.9508 (1.0); 6.9478 (0.9); 6.8944
(1.4); 6.8880 (1.8); 6.8813 (1.1); 6.5426 (0.4); 6.5226 (0.8); 6.5030 (0.4); 5.3373 (3.0); 4.2577 (0.8);
4.2367 (0.8); 4.2092 (1.8); 4.1882 (1.7); 4.1606 (0.9); 4.1396 (0.8); 2.5263 (5.2); 2.5196 (3.0); 2.3521
(16.0); 2.3441 (7.8); 1.9528 (0.5); 1.9415 (0.5); 1.9248 (1.0); 1.9134 (0.4); 1.9080 (0.5); 1.8968 (0.5);
1.5920 (2.4); 1.0326 (0.6); 1.0174 (1.6); 1.0106 (1.8); 1.0049 (1.0); 0.9957 (1.0); 0.9890 (1.8); 0.9823
(1.6); 0.9677 (0.8); 0.7511 (0.8); 0.7359 (2.0); 0.7297 (1.8); 0.7195 (1.7); 0.7137 (2.2); 0.6974 (0.6);
0.0393 (8.5)
I-064: ¹H-NMR(300.2 MHz, CDCl3):
δ = 7.5316 (0.3); 7.5084 (1.0); 7.4364 (0.5); 7.3907 (0.4); 7.3823 (0.6); 7.3553 (0.6); 7.2983 (2.8);
7.0800 (0.5); 4.1765 (0.4); 4.1557 (0.4); 3.3426 (0.7); 3.3263 (0.7); 2.4992 (1.5); 2.4921 (0.8); 2.3427
(2.1); 1.5893 (2.0); 1.3507 (6.6); 0.2343 (0.8); 0.2233 (16.0); 0.2137 (0.5); 0.2123 (0.6); 0.0384 (3.0)
I-065: ¹H-NMR(300.2 MHz, CDCl3):
δ = 8.2969 (13.4); 8.0973 (0.8); 8.0806 (1.4); 7.5107 (1.8); 7.4846 (4.3); 7.4582 (2.7); 7.3709 (3.6);
7.3444 (4.1); 7.2985 (26.4); 7.2673 (2.6); 7.2409 (2.1); 7.1761 (1.7); 7.1707 (2.4); 7.1407 (4.8);
7.1340 (3.9); 7.0734 (3.9); 6.9868 (2.1); 6.9603 (1.8); 4.2952 (2.0); 4.2753 (1.9); 4.2470 (4.3); 4.2271
(4.1); 4.1986 (2.3); 4.1789 (2.2); 4.1726 (1.3); 4.1487 (1.0); 4.1248 (0.3); 2.8917 (0.8); 2.8644 (0.9);
2.8502 (1.2); 2.8233 (1.3); 2.8094 (0.9); 2.7822 (0.9); 2.5181 (6.4); 2.5112 (11.8); 2.5037 (6.5);
2.3244 (16.0); 2.0836 (4.7); 2.0442 (2.1); 1.9862 (0.7); 1.9694 (0.8); 1.9596 (0.9); 1.9453 (1.2);
1.9292 (1.1); 1.9194 (1.3); 1.9034 (1.4); 1.8896 (0.7); 1.8798 (0.9); 1.8629 (0.9); 1.7413 (0.8); 1.7280
(0.9); 1.7144 (1.5); 1.7009 (1.9); 1.6862 (1.3); 1.6722 (1.8); 1.6588 (1.7); 1.6452 (1.0); 1.6320 (1.1);
1.5941 (1.5); 1.3219 (1.3); 1.2981 (2.7); 1.2743 (1.2); 0.1087 (1.2); 0.0497 (1.2); 0.0389 (32.4);
0.0280 (1.1)
I-066: ¹H-NMR(400.2 MHz, d₆-DMSO):
δ = 9.3253 (0.5); 9.3056 (0.5); 9.1648 (1.4); 9.1451 (1.4); 8.8116 (0.6); 8.8085 (0.7); 8.8005 (0.7);
8.7974 (0.7); 8.7574 (0.6); 8.7545 (0.6); 8.7365 (0.7); 8.7335 (0.6); 8.4007 (2.5); 7.7066 (0.6); 7.6874
(1.7); 7.6683 (1.9); 7.6576 (1.2); 7.6477 (0.8); 7.6362 (2.0); 7.6291 (3.0); 7.6083 (1.3); 7.5899 (2.3);
7.5627 (0.6); 7.5315 (1.4); 7.5091 (1.1); 7.4915 (7.7); 7.4665 (1.2); 7.4452 (1.7); 7.4093 (3.0); 7.3881
(5.1); 7.3633 (2.0); 7.3469 (0.7); 7.3419 (1.6); 7.3383 (1.3); 7.3324 (5.9); 7.3158 (1.4); 7.3111 (3.3);
5.1550 (0.4); 5.1012 (0.8); 5.0830 (1.2); 5.0647 (0.8); 3.9924 (16.0); 3.9031 (3.9); 3.4801 (0.5);
3.3277 (98.7); 2.6759 (0.8); 2.6715 (1.1); 2.6670 (0.8); 2.5247 (4.8); 2.5112 (74.4); 2.5070 (142.2);
2.5026 (181.2); 2.4981 (132.5); 2.4939 (67.8); 2.3338 (0.8); 2.3293 (1.0); 2.3249 (0.8); 1.4717 (2.0);
1.4543 (2.0); 1.4169 (6.0); 1.3994 (6.0); 1.3765 (0.6); 1.2355 (0.4); −0.0001 (0.7)
I-067: ¹H-NMR(400.0 MHz, CD3CN):
δ = 7.9759 (16.0); 7.9610 (0.3); 7.8057 (1.6); 7.7210 (1.4); 7.7016 (4.6); 7.6819 (7.1); 7.6759 (6.6);
7.6563 (1.7); 7.5779 (1.7); 7.5552 (7.5); 7.5405 (3.5); 7.5186 (1.8); 7.5035 (3.8); 7.4849 (2.9); 7.0514
(1.6); 7.0460 (1.6); 7.0232 (3.0); 7.0004 (1.4); 6.9950 (1.5); 6.9135 (1.6); 6.9090 (1.5); 6.8920 (3.0);
6.8707 (1.5); 5.4454 (1.4); 4.2524 (3.2); 4.2360 (3.2); 4.2182 (6.6); 4.2018 (6.5); 4.1839 (3.3); 4.1675
(3.3); 4.0677 (0.4); 4.0499 (0.4); 2.1321 (8.3); 1.9712 (1.9); 1.9633 (1.1); 1.9571 (2.7); 1.9514 (13.1);
1.9453 (23.5); 1.9392 (31.4); 1.9330 (21.6); 1.9268 (11.1); 1.2686 (0.6); 1.2214 (0.5); 1.2036 (0.9);
1.1857 (0.5); 0.9756 (0.4); 0.1460 (0.4); 0.0078 (3.1); −0.0002 (69.0); −0.1496 (0.4)
I-068: ¹H-NMR(400.0 MHz, d₆-DMSO):
δ = 8.8340 (1.7); 8.8202 (3.4); 8.8063 (1.7); 8.7328 (5.5); 8.0979 (16.0); 7.9143 (2.9); 7.9085 (3.0);
7.8937 (3.3); 7.8880 (3.3); 7.7372 (1.3); 7.7177 (4.4); 7.6979 (5.9); 7.6906 (6.1); 7.6710 (1.8); 7.6267
(6.1); 7.5615 (3.6); 7.5349 (5.9); 7.5138 (4.6); 3.7726 (2.2); 3.7567 (6.0); 3.7413 (6.2); 3.7255 (2.5);
3.3433 (50.4); 3.1469 (4.0); 3.1305 (7.7); 3.1142 (3.7); 2.8945 (0.5); 2.7357 (0.5); 2.5115 (23.4);
2.5074 (30.8); 2.5031 (22.9); 1.2396 (1.2); −0.0002 (4.0)
I-069: ¹H-NMR(400.1 MHz, d₆-DMSO):
δ = 9.1170 (1.9); 9.1015 (4.0); 9.0855 (2.1); 8.2929 (0.3); 8.2140 (15.5); 7.9610 (1.4); 7.8416 (7.6);
7.6666 (1.9); 7.6467 (4.9); 7.6267 (3.8); 7.5725 (4.9); 7.5529 (3.3); 7.5308 (16.0); 7.4424 (2.6);
7.4380 (2.6); 7.4211 (5.2); 7.4169 (5.5); 7.3801 (9.6); 7.3690 (6.9); 7.3592 (5.9); 7.3183 (3.6); 7.2979
(3.3); 7.2934 (3.0); 4.1716 (1.9); 4.1560 (2.1); 4.1371 (4.3); 4.1214 (4.4); 4.1024 (2.4); 4.0867 (2.2);
3.3133 (201.7); 2.8994 (8.5); 2.7404 (7.8); 2.5137 (23.8); 2.5094 (32.9); 2.5051 (25.3); 2.4545 (0.5)
I-070: ¹H-NMR(400.1 MHz, d₆-DMSO):
δ = 9.3418 (1.9); 9.3263 (4.0); 9.3105 (2.0); 7.9619 (2.6); 7.8969 (6.7); 7.8934 (6.7); 7.7706 (1.5);
7.7507 (4.4); 7.7311 (4.2); 7.7125 (5.3); 7.6927 (2.4); 7.6190 (6.1); 7.5672 (3.5); 7.5475 (2.9); 7.4987
(4.5); 7.4775 (7.4); 7.4203 (4.5); 7.4164 (4.4); 7.3995 (2.8); 7.3952 (2.8); 4.3606 (1.6); 4.3448 (1.8);
4.3253 (3.6); 4.3097 (3.6); 4.2894 (2.0); 4.2738 (1.9); 3.5458 (4.2); 3.5282 (9.5); 3.5108 (5.0); 3.3148
(40.0); 3.2544 (44.9); 3.2324 (1.3); 3.2037 (0.5); 2.8997 (16.0); 2.8783 (4.3); 2.8609 (7.8); 2.8433
(4.0); 2.7407 (14.4); 2.5140 (25.0); 2.5098 (33.4); 2.5055 (25.2)
I-071: ¹H-NMR(400.1 MHz, d₆-DMSO):
δ = 8.9675 (3.6); 8.9468 (3.6); 8.3636 (0.4); 8.3376 (15.3); 7.9609 (1.4); 7.7911 (0.4); 7.7725 (16.0);
7.6337 (2.0); 7.6139 (4.8); 7.5939 (3.3); 7.5250 (4.7); 7.5058 (3.1); 7.3417 (6.1); 7.3074 (3.6); 7.2868
(3.0); 6.6696 (15.1); 4.8696 (0.9); 4.8500 (2.0); 4.8377 (1.9); 4.8201 (1.0); 3.3128 (175.6); 2.8992
(9.4); 2.7400 (8.4); 2.6506 (0.3); 2.6093 (4.1); 2.5992 (4.3); 2.5582 (0.5); 2.5134 (21.3); 2.5090
(28.8); 2.5047 (21.3); 1.8432 (0.6); 1.8122 (3.0); 1.7994 (3.3); 1.7870 (3.0); 1.7538 (0.9); 1.7407
(0.6); 1.7150 (1.3); 1.6971 (1.4); 1.6819 (1.1); 1.6560 (0.5); 1.5460 (0.3); 1.5267 (1.1); 1.5078 (1.9);
1.4859 (1.6); 1.4610 (0.8)
I-072: ¹H-NMR(499.9 MHz, CDCl3):
δ = 7.5664 (3.0); 7.5626 (2.5); 7.5573 (4.4); 7.4545 (2.5); 7.4051 (1.0); 7.3969 (1.4); 7.3933 (1.2);
7.3875 (1.0); 7.3825 (0.6); 7.3196 (2.2); 7.3036 (2.3); 7.2598 (3.8); 6.9924 (2.8); 6.8282 (1.5); 6.8124
(1.4); 6.5730 (0.7); 6.5655 (0.9); 6.5583 (0.8); 6.5511 (0.7); 5.2962 (2.5); 4.5774 (0.4); 4.5717 (0.4);
4.5612 (0.4); 4.5550 (0.4); 4.5507 (0.4); 4.5448 (0.5); 4.5339 (0.3); 4.5285 (0.4); 3.8495 (0.3); 3.8405
(0.4); 3.8306 (0.5); 3.8211 (0.5); 3.8127 (0.5); 3.8045 (0.4); 3.1446 (16.0); 2.4477 (7.7); 2.2214
(10.3); 1.2555 (0.7); −0.0002 (4.7)
I-073: ¹H-NMR(400.0 MHz, CD3CN):
δ = 8.2415 (6.0); 8.2366 (6.3); 8.1662 (1.5); 8.0912 (16.0); 8.0065 (6.6); 8.0015 (6.3); 7.7094 (1.0);
7.6897 (4.0); 7.6718 (11.1); 7.6544 (1.0); 7.5141 (5.4); 7.4684 (2.0); 7.4629 (3.6); 7.4577 (2.1);
7.4524 (1.4); 7.4458 (2.6); 4.4476 (3.2); 4.4313 (3.2); 4.4145 (6.8); 4.3982 (6.7); 4.3814 (3.4); 4.3651
(3.4); 2.1293 (18.4); 1.9635 (1.3); 1.9574 (3.2); 1.9516 (17.3); 1.9454 (31.3); 1.9393 (42.1); 1.9331
(29.2); 1.9269 (15.1); 1.2685 (0.4); 0.1460 (0.4); 0.0079 (3.7); −0.0002 (93.6); −0.0084
(4.2); −0.1497 (0.5)
I-074: ¹H-NMR(400.1 MHz, d₆-DMSO):
δ = 9.1051 (0.9); 9.0909 (1.9); 9.0759 (1.0); 7.9619 (1.9); 7.7580 (3.6); 7.7227 (0.9); 7.7030 (2.4);
7.6831 (1.9); 7.6470 (2.5); 7.6289 (1.7); 7.5354 (3.0); 7.5207 (1.2); 7.5162 (1.1); 7.4997 (4.6); 7.4957
(3.9); 7.4802 (6.1); 7.4592 (1.7); 7.2873 (0.4); 6.0275 (0.6); 6.0151 (1.2); 6.0026 (0.6); 5.9121 (0.6);
5.8997 (1.3); 5.8870 (0.6); 3.9219 (1.1); 3.9083 (1.8); 3.8944 (1.1); 3.8638 (1.1); 3.8499 (1.9); 3.8361
(1.1); 3.3153 (20.8); 2.9308 (0.3); 2.8997 (11.6); 2.7407 (10.4); 2.5463 (16.4); 2.5141 (12.1); 2.5098
(16.2); 2.5055 (12.3); 2.1730 (16.0)
I-075: ¹H-NMR(400.2 MHz, d₆-DMSO):
δ = 8.7145 (2.2); 8.7012 (1.2); 8.3161 (0.6); 8.0485 (16.0); 8.0174 (0.5); 8.0020 (0.3); 7.7353 (1.0);
7.7159 (3.2); 7.6964 (3.9); 7.6874 (4.4); 7.6679 (1.3); 7.5737 (4.4); 7.5059 (2.7); 7.4868 (2.1); 7.4575
(5.0); 7.4364 (6.0); 7.3309 (6.6); 7.3254 (7.5); 7.2738 (3.8); 7.2683 (3.2); 7.2528 (3.1); 7.2473 (2.7);
3.9026 (3.8); 3.5662 (1.4); 3.5538 (5.4); 3.5419 (5.5); 3.5200 (1.2); 3.5024 (0.5); 3.3273 (189.8);
2.6758 (1.4); 2.6713 (1.8); 2.6668 (1.3); 2.5415 (1.3); 2.5246 (7.1); 2.5111 (124.7); 2.5068 (240.1);
2.5024 (305.1); 2.4978 (218.3); 2.4934 (106.6); 2.3336 (1.3); 2.3291 (1.8); 2.3246 (1.3); 1.4451 (1.2);
1.2587 (0.5); 1.2347 (0.9); 1.2134 (8.5); 1.1974 (8.5); −0.0002 (1.3)
I-076: ¹H-NMR(300.2 MHz, CDCl3):
δ = 8.8055 (3.8); 8.8003 (2.6); 8.7906 (2.6); 8.7854 (3.8); 7.6537 (0.3); 7.6276 (1.8); 7.6073 (5.5);
7.6040 (4.5); 7.5868 (0.5); 7.5408 (2.4); 7.5281 (0.5); 7.5107 (1.1); 7.5015 (1.7); 7.4942 (1.1); 7.4802
(1.0); 7.4732 (0.6); 7.3619 (4.9); 7.3564 (3.1); 7.3472 (3.1); 7.3417 (4.9); 7.3166 (0.4); 7.2985 (24.7);
7.2380 (2.1); 7.2114 (2.5); 7.0425 (2.6); 6.9919 (1.8); 6.9652 (1.5); 6.9388 (1.2); 6.3845 (0.6); 6.3640
(1.1); 6.3442 (0.6); 4.0355 (1.2); 4.0150 (1.1); 3.9858 (2.5); 3.9653 (2.4); 3.9362 (1.3); 3.9155 (1.2);
3.6584 (4.1); 2.3930 (7.6); 2.3858 (4.4); 2.3633 (0.5); 2.3520 (0.4); 2.3135 (10.2); 1.6201 (16.0);
1.2921 (0.6); 0.0475 (0.8); 0.0367 (21.6); 0.0257 (0.8)
I-077: ¹H-NMR(499.9 MHz, CDCl3):
δ = 7.8886 (0.9); 7.8784 (1.3); 7.5633 (0.4); 7.5531 (0.4); 7.5359 (0.9); 7.5205 (2.1); 7.5050 (4.7);
7.4889 (0.9); 7.4594 (3.0); 7.3873 (1.8); 7.3731 (1.3); 7.2594 (8.4); 7.0891 (2.3); 7.0737 (2.6); 6.9596
(3.3); 6.8904 (1.8); 6.8753 (1.5); 4.1832 (8.2); 3.7709 (1.4); 3.7573 (3.1); 3.7449 (3.0); 3.7313 (1.2);
3.1916 (16.0); 3.0161 (0.4); 2.9468 (2.4); 2.9329 (4.3); 2.9188 (2.1); 2.3019 (14.8); 2.2812 (1.5);
2.2672 (14.1); 2.2410 (0.4); 2.2228 (0.4); 2.2172 (0.6); 2.0834 (0.5); 2.0233 (15.4); 2.0021 (1.4);
1.4148 (1.2); 1.2552 (0.7); 1.1080 (3.6); 0.9900 (0.4); −0.0002 (8.3)
I-078: ¹H-NMR(499.9 MHz, d₆-DMSO):
δ = 9.0968 (1.4); 9.0854 (2.4); 9.0736 (1.3); 7.7752 (1.0); 7.7593 (2.3); 7.7429 (2.0); 7.7233 (3.3);
7.7081 (1.6); 7.5128 (5.6); 7.2891 (2.7); 7.2734 (2.8); 7.0235 (4.2); 6.7944 (2.4); 6.7788 (2.1); 4.4041
(0.4); 3.7558 (0.4); 3.5092 (16.0); 3.3192 (22.2); 2.5019 (26.1); 2.3838 (11.1); 2.1616 (13.7)
I-079: ¹H-NMR(400.0 MHz, CD3CN):
δ = 7.9732 (16.0); 7.9006 (0.4); 7.7317 (1.3); 7.7121 (4.2); 7.6926 (4.8); 7.6833 (5.4); 7.6638 (1.7);
7.5980 (1.3); 7.5828 (1.1); 7.5552 (5.4); 7.4883 (3.2); 7.4689 (2.5); 7.3770 (7.5); 7.3715 (7.7); 7.3134
(7.5); 7.2927 (8.3); 6.9383 (4.5); 6.9329 (4.4); 6.9176 (4.0); 6.9122 (3.9); 5.4454 (7.3); 4.0675 (0.5);
4.0497 (0.6); 3.6129 (7.7); 3.5974 (7.7); 2.1296 (8.6); 1.9711 (2.4); 1.9634 (1.0); 1.9574 (2.5); 1.9515
(13.4); 1.9454 (24.2); 1.9392 (32.4); 1.9330 (22.2); 1.9269 (11.4); 1.2681 (0.6); 1.2214 (0.6); 1.2036
(1.2); 1.1857 (0.6); 1.0891 (3.4); 1.0766 (10.2); 1.0731 (10.2); 1.0613 (4.3); 1.0241 (0.4); 0.9008
(0.4); 0.8803 (0.4); 0.8760 (0.4); 0.8632 (4.2); 0.8512 (10.0); 0.8480 (10.1); 0.8354 (3.3); 0.1459
(0.4); 0.0079 (2.8); −0.0002 (73.0); −0.0085 (2.8); −0.1497 (0.3)
I-080: ¹H-NMR(400.1 MHz, CDCl3):
δ = 8.2612 (5.6); 8.0275 (0.8); 8.0161 (1.4); 7.4157 (1.4); 7.4115 (2.1); 7.3962 (4.5); 7.3909 (2.8);
7.3761 (1.6); 7.2622 (8.3); 7.2305 (1.5); 7.2194 (1.6); 7.2139 (2.1); 7.1985 (1.3); 7.1936 (1.2); 7.0804
(1.5); 7.0756 (2.4); 7.0708 (1.5); 6.9711 (1.2); 6.9665 (1.1); 6.9512 (1.1); 6.9464 (1.0); 6.0745 (0.5);
6.0667 (0.5); 6.0571 (0.5); 6.0492 (0.5); 5.9582 (0.5); 5.9504 (0.5); 5.9408 (0.5); 5.9330 (0.5); 4.2364
(0.3); 4.2279 (0.3); 4.2197 (0.4); 4.1780 (0.3); 4.1698 (0.3); 4.1614 (0.3); 3.8356 (0.4); 3.8311 (0.3);
3.8181 (0.3); 3.7946 (0.6); 3.7816 (0.6); 3.7641 (0.3); 2.9568 (6.7); 2.8836 (6.3); 2.5082 (16.0);
1.5752 (5.8); −0.0002 (2.3)
I-081: ¹H-NMR(300.2 MHz, CDCl3):
δ = 7.6023 (0.5); 7.5761 (3.0); 7.5675 (2.5); 7.5635 (2.8); 7.5571 (8.0); 7.5538 (7.5); 7.5421 (0.6);
7.5379 (0.6); 7.4811 (3.6); 7.4606 (0.5); 7.4541 (0.4); 7.4455 (1.6); 7.4341 (2.3); 7.4272 (2.1); 7.4147
(1.6); 7.4070 (0.9); 7.3821 (3.5); 7.3554 (4.0); 7.2983 (16.5); 7.0825 (4.0); 7.0098 (2.2); 6.9836 (1.9);
6.7410 (2.6); 6.7018 (3.0); 6.6820 (3.3); 6.6428 (3.4); 6.4092 (1.0); 6.3894 (1.8); 6.3691 (1.0); 6.1084
(6.0); 6.0494 (5.0); 5.8475 (6.0); 5.8082 (5.5); 4.2481 (2.0); 4.2274 (1.8); 4.1990 (4.2); 4.1783 (3.9);
4.1498 (2.1); 4.1291 (2.0); 2.5062 (12.0); 2.4993 (6.8); 2.3918 (0.4); 2.3575 (0.3); 2.3235 (16.0);
1.6009 (12.3); 1.2921 (0.4); 0.0480 (0.5); 0.0373 (13.7); 0.0279 (0.4); 0.0264 (0.5)
I-082: ¹H-NMR(400.1 MHz, d₆-DMSO):
δ = 9.1835 (1.2); 9.1682 (2.5); 9.1527 (1.3); 8.2970 (11.6); 7.7924 (0.9); 7.7731 (2.8); 7.7536 (3.2);
7.7412 (3.9); 7.7108 (4.3); 7.6429 (2.5); 7.6233 (1.9); 7.3224 (3.5); 7.3024 (3.9); 7.0704 (4.3); 6.9036
(2.3); 6.8835 (2.2); 4.1667 (1.2); 4.1512 (1.2); 4.1300 (2.7); 4.1144 (2.7); 4.0932 (1.5); 4.0776 (1.4);
3.3012 (12.6); 2.5049 (9.3); 2.5005 (12.4); 2.4961 (9.2); 2.4216 (11.4); 2.2057 (16.0); 2.0715
(1.7); −0.0002 (4.1)
I-083: ¹H-NMR(300.2 MHz, CDCl3):
δ = 7.5788 (0.8); 7.5735 (0.5); 7.5641 (1.2); 7.5613 (1.4); 7.5462 (0.9); 7.5173 (1.2); 7.4686 (0.7);
7.4497 (0.4); 7.4152 (0.4); 7.4003 (0.7); 7.3937 (1.5); 7.3647 (0.8); 7.2987 (2.8); 4.2126 (0.6); 4.1917
(0.6); 4.1652 (0.3); 2.7897 (1.3); 1.7460 (2.9); 1.6093 (16.0); 0.0326 (3.1)
I-084: ¹H-NMR(400.0 MHz, d₆-DMSO):
δ = 8.9551 (1.3); 8.9346 (1.3); 7.9562 (1.2); 7.7585 (6.3); 7.6933 (0.6); 7.6737 (1.7); 7.6565 (2.2);
7.6390 (2.2); 7.6308 (1.9); 7.6110 (0.8); 7.5671 (2.2); 7.5120 (1.2); 7.4920 (0.9); 7.3862 (1.9); 7.3656
(2.3); 7.2924 (4.3); 7.1282 (1.0); 7.1103 (1.7); 7.0922 (0.9); 7.0900 (1.0); 6.9004 (1.1); 6.8823 (1.9);
6.8631 (0.9); 5.4628 (0.7); 5.4447 (1.1); 5.4261 (0.8); 3.7143 (16.0); 3.3871 (126.0); 2.8954 (8.0);
2.7373 (7.1); 2.5910 (15.2); 2.5317 (0.3); 2.5269 (0.5); 2.5184 (7.5); 2.5140 (15.8); 2.5095 (21.3);
2.5050 (15.4); 2.5006 (7.4); 1.6015 (5.8); 1.5845 (5.7)
I-085: ¹H-NMR(300.2 MHz, CDCl3):
δ = 7.5558 (2.7); 7.5512 (1.8); 7.5384 (4.0); 7.5248 (0.3); 7.4747 (1.9); 7.4280 (2.1); 7.4183 (1.8);
7.4120 (2.4); 7.4079 (2.1); 7.3999 (3.2); 7.3892 (0.9); 7.3823 (1.2); 7.3757 (1.0); 7.3666 (0.7); 7.3586
(0.5); 7.2986 (1.7); 7.2319 (2.0); 7.2254 (2.2); 7.2043 (2.3); 7.1975 (1.6); 7.1861 (0.6); 6.0481 (0.4);
6.0383 (0.5); 6.0246 (0.5); 6.0147 (0.5); 5.8927 (0.5); 5.8828 (0.5); 5.8692 (0.5); 5.8592 (0.5); 5.3306
(0.6); 4.1644 (0.4); 4.1408 (0.7); 4.1363 (0.4); 4.1258 (0.4); 4.1170 (0.9); 4.1046 (0.4); 4.0940 (0.6);
4.0727 (0.6); 4.0453 (0.4); 4.0350 (0.3); 4.0241 (0.4); 3.8956 (0.4); 3.8928 (0.4); 3.8723 (0.4); 3.8674
(0.3); 3.8433 (0.6); 3.8232 (0.6); 3.7994 (0.4); 3.7942 (0.3); 3.7709 (0.3); 2.3148 (16.0); 2.0630 (3.8);
1.3072 (0.9); 1.2894 (1.2); 1.2834 (1.9); 1.2596 (0.9); 0.9886 (0.3); 0.9642 (0.6); 0.0331 (1.4)
I-086: ¹H-NMR(400.1 MHz, CDCl3):
δ = 8.2682 (10.5); 8.0280 (1.7); 8.0162 (3.3); 7.4785 (2.0); 7.4588 (4.5); 7.4390 (2.8); 7.4100 (3.3);
7.3895 (7.9); 7.2618 (20.2); 7.2372 (3.1); 7.2179 (2.6); 7.1961 (3.0); 7.1914 (2.7); 7.1753 (2.4);
7.1705 (2.4); 7.1290 (2.0); 7.1242 (2.6); 7.1039 (2.7); 7.0909 (4.4); 6.0772 (0.9); 6.0691 (1.1); 6.0598
(1.1); 6.0518 (1.0); 5.9610 (0.9); 5.9529 (1.1); 5.9434 (1.1); 5.9355 (1.0); 4.2866 (0.4); 4.2783 (0.5);
4.2697 (0.5); 4.2620 (0.5); 4.2500 (0.6); 4.2416 (0.6); 4.2331 (0.6); 4.2243 (0.7); 4.2124 (0.5); 4.2039
(0.5); 4.1959 (0.5); 4.1834 (0.6); 4.1752 (0.6); 4.1671 (0.6); 4.1590 (0.6); 3.8498 (0.4); 3.8358 (0.7);
3.8178 (0.6); 3.7989 (1.0); 3.7822 (1.0); 3.7643 (0.6); 3.7454 (0.6); 3.7289 (0.4); 2.9566 (16.0);
2.8834 (14.9); 2.8480 (0.9); 2.8277 (1.0); 2.8172 (1.5); 2.7967 (1.6); 2.7863 (1.1); 2.7659 (1.0);
1.9377 (0.6); 1.9252 (0.6); 1.9179 (0.7); 1.9068 (1.4); 1.8952 (1.1); 1.8877 (1.3); 1.8756 (1.5); 1.8653
(0.7); 1.8579 (0.7); 1.8453 (0.7); 1.6940 (0.5); 1.6844 (0.5); 1.6740 (0.9); 1.6638 (1.4); 1.6537 (1.0);
1.6434 (1.3); 1.6321 (1.0); 1.6236 (0.5); 1.6125 (0.5); 1.5701 (18.5); −0.0002 (5.8)
I-087: ¹H-NMR(400.2 MHz, d₆-DMSO):
δ = 9.2187 (2.0); 9.2033 (4.2); 9.1877 (2.0); 8.3169 (0.6); 7.9848 (16.0); 7.7582 (1.8); 7.7390 (4.7);
7.7167 (10.0); 7.7116 (9.5); 7.6856 (2.6); 7.6573 (6.6); 7.5723 (3.8); 7.5528 (3.1); 7.5139 (5.8);
7.4929 (6.9); 7.2984 (4.1); 7.2949 (4.0); 7.2779 (3.5); 7.2739 (3.4); 4.2910 (1.9); 4.2750 (2.1); 4.2556
(4.1); 4.2400 (4.0); 4.2207 (2.2); 4.2048 (2.2); 4.1893 (2.5); 4.1636 (6.8); 4.1380 (7.0); 4.1124 (2.4);
3.9029 (3.3); 3.3294 (262.4); 2.6757 (2.3); 2.6717 (2.9); 2.6676 (2.3); 2.5069 (404.2); 2.5027 (494.5);
2.4985 (369.1); 2.3338 (2.2); 2.3294 (2.8); 2.3253 (2.2); 1.2984 (0.4); 1.2670 (0.4); 1.2581 (0.6);
1.2355 (1.0); 0.8616 (0.5); 0.8432 (0.5); −0.0002 (1.6)
I-088: ¹H-NMR(400.1 MHz, d₆-DMSO):
δ = 9.3739 (3.2); 9.3544 (3.2); 8.6198 (16.0); 7.9592 (1.2); 7.7928 (1.5); 7.7747 (9.2); 7.7621 (6.6);
7.7543 (8.1); 7.7469 (8.1); 7.7298 (4.6); 7.6864 (3.5); 7.6675 (2.2); 7.6050 (1.9); 7.5853 (4.6); 7.5703
(3.7); 7.5517 (3.7); 7.5326 (1.2); 5.2991 (0.5); 5.2812 (1.9); 5.2632 (2.8); 5.2449 (1.9); 5.2264 (0.5);
3.3184 (59.9); 2.8967 (7.6); 2.7377 (6.6); 2.6806 (0.6); 2.6763 (0.8); 2.6716 (0.6); 2.5116 (98.7);
2.5072 (127.6); 2.5029 (91.6); 2.3387 (0.6); 2.3340 (0.8); 2.3296 (0.5); 1.5060 (13.2); 1.4884 (13.0)
I-089: ¹H-NMR(300.2 MHz, CDCl3):
δ = 8.1049 (0.8); 8.0869 (1.5); 8.0692 (0.9); 7.8663 (10.5); 7.6212 (0.6); 7.5953 (2.5); 7.5720 (7.4);
7.5489 (0.7); 7.4607 (3.6); 7.4261 (1.5); 7.4179 (2.5); 7.4105 (1.3); 7.3954 (1.6); 7.3553 (3.5); 7.3287
(4.0); 7.3046 (15.6); 7.0698 (3.9); 6.9752 (2.1); 6.9488 (1.8); 5.4528 (2.6); 4.2978 (1.8); 4.2779 (1.8);
4.2498 (3.9); 4.2299 (3.8); 4.2018 (2.0); 4.1819 (1.8); 2.6877 (0.7); 2.6725 (1.1); 2.6657 (1.4); 2.6614
(1.4); 2.6540 (1.2); 2.6439 (0.8); 2.6323 (0.4); 2.5152 (11.5); 2.5081 (6.5); 2.3200 (16.0); 1.6668
(1.1); 1.2985 (1.1); 0.9426 (1.0); 0.9246 (3.3); 0.9197 (4.0); 0.9031 (4.3); 0.8975 (3.4); 0.8811 (1.3);
0.6604 (1.2); 0.6447 (3.4); 0.6375 (4.1); 0.6267 (3.3); 0.6097 (1.0); 0.1141 (0.4); 0.0543 (0.5); 0.0436
(15.3); 0.0327 (0.6)
I-090: ¹H-NMR(300.2 MHz, CDCl3):
δ = 8.5678 (9.0); 7.9182 (0.7); 7.9009 (1.1); 7.8848 (0.6); 7.6785 (6.4); 7.6618 (5.6); 7.5315 (2.6);
7.5088 (1.5); 7.4806 (5.5); 7.4635 (4.1); 7.4583 (3.5); 7.4476 (1.8); 7.4409 (1.6); 7.4310 (1.8); 7.2994
(29.5); 4.4860 (1.4); 4.4654 (1.5); 4.4375 (3.1); 4.4171 (3.0); 4.3891 (1.6); 4.3686 (1.5); 4.1728 (0.3);
4.1488 (0.4); 2.0841 (1.5); 1.5788 (16.0); 1.3222 (1.2); 1.3058 (3.1); 1.2987 (3.4); 1.2749 (0.7);
0.9429 (1.0); 0.9212 (3.2); 0.8979 (1.2); 0.0497 (1.0); 0.0390 (28.5); 0.0282 (1.3)
I-091: ¹H-NMR(400.0 MHz, d₆-DMSO):
δ = 9.2543 (1.4); 9.2351 (1.5); 7.8131 (6.2); 7.7246 (0.6); 7.7048 (1.7); 7.6856 (1.5); 7.6587 (1.3);
7.6442 (2.8); 7.6369 (7.5); 7.6279 (9.2); 7.6065 (1.3); 7.5728 (1.4); 7.5517 (1.1); 5.2156 (0.8); 5.1977
(1.2); 5.1796 (0.8); 3.3806 (61.2); 2.8934 (1.1); 2.7350 (1.0); 2.6169 (16.0); 2.5172 (5.7); 2.5128
(12.3); 2.5083 (16.7); 2.5038 (12.2); 2.4994 (6.0); 1.4706 (6.2); 1.4530 (6.2)
I-092: ¹H-NMR(300.2 MHz, CDCl3):
δ = 7.5933 (3.5); 7.5728 (3.8); 7.5697 (3.2); 7.5575 (0.3); 7.5521 (0.3); 7.4972 (1.7); 7.4363 (0.7);
7.4268 (1.4); 7.4192 (0.9); 7.4133 (0.6); 7.4005 (3.0); 7.3951 (3.3); 7.3898 (3.8); 7.3619 (0.5); 7.2986
(7.5); 6.6149 (0.4); 6.5947 (0.8); 6.5751 (0.4); 6.0797 (0.5); 6.0694 (0.5); 6.0560 (0.5); 6.0459 (0.5);
5.9241 (0.5); 5.9140 (0.5); 5.9005 (0.5); 5.8902 (0.5); 5.3367 (3.6); 4.2267 (0.3); 4.2164 (0.3); 4.2046
(0.3); 4.1943 (0.4); 4.1858 (0.8); 4.1622 (1.9); 4.1382 (1.9); 4.1259 (0.4); 4.1146 (1.1); 4.1039 (0.4);
4.0931 (0.5); 3.9309 (0.4); 3.9269 (0.4); 3.9074 (0.4); 3.8778 (0.6); 3.8583 (0.6); 3.8347 (0.4); 3.8288
(0.4); 2.4220 (16.0); 2.0777 (9.1); 2.0401 (0.4); 1.6210 (3.1); 1.3171 (2.1); 1.2932 (4.8); 1.2694 (2.1);
0.9947 (0.4); 0.9702 (0.8); 0.9458 (0.3); 0.1062 (0.4); 0.0356 (6.6)
I-093: ¹H-NMR(300.2 MHz, CDCl3):
δ = 7.5525 (0.4); 7.5262 (1.4); 7.5047 (4.2); 7.4832 (0.4); 7.4133 (3.8); 7.3868 (2.2); 7.3668 (0.9);
7.3578 (1.4); 7.3505 (0.9); 7.3432 (0.6); 7.3365 (0.9); 7.2983 (12.0); 7.1082 (2.2); 7.0500 (1.2);
7.0224 (1.0); 6.6085 (0.6); 6.5880 (1.1); 6.5680 (0.6); 4.8218 (0.3); 4.7868 (16.0); 4.5734 (11.3);
4.2706 (0.9); 4.2497 (0.8); 4.2211 (1.8); 4.2001 (1.7); 4.1715 (0.9); 4.1506 (0.9); 2.5347 (6.3); 2.3648
(8.4); 2.0422 (0.7); 1.6009 (4.7); 0.1074 (0.9); 0.0482 (0.5); 0.0376 (11.7); 0.0267 (0.5)
I-094: ¹H-NMR(300.2 MHz, CDCl3):
δ = 9.1323 (0.4); 8.3939 (4.9); 7.6216 (0.4); 7.6175 (0.4); 7.6060 (3.6); 7.6025 (3.4); 7.5951 (1.5);
7.5905 (1.6); 7.5847 (1.8); 7.3479 (1.6); 7.2985 (6.0); 7.2863 (0.8); 7.2774 (0.9); 7.2655 (1.0); 7.2589
(0.9); 7.2478 (0.5); 7.0267 (1.7); 7.0012 (2.0); 6.9123 (1.9); 6.7390 (1.1); 6.7134 (0.9); 4.2143 (1.1);
4.1931 (2.0); 4.1750 (1.9); 4.1523 (1.1); 3.1164 (1.7); 3.0940 (2.8); 3.0719 (1.5); 2.7454 (1.0); 2.7349
(16.0); 2.3162 (10.9); 2.1973 (10.0); 1.5963 (1.4); 1.2950 (1.1); 0.0393 (6.1)
I-095: ¹H-NMR(400.2 MHz, d₆-DMSO):
δ = 11.8389 (1.6); 7.9539 (0.6); 7.8445 (5.6); 7.7185 (0.7); 7.6988 (2.0); 7.6793 (2.9); 7.6581 (8.4);
7.6506 (8.5); 7.6344 (1.6); 7.6293 (1.6); 7.5596 (2.4); 7.5227 (1.4); 7.5030 (1.1); 5.0568 (6.6); 3.3361
(28.8); 2.8932 (3.7); 2.7347 (3.3); 2.5975 (16.0); 2.5755 (0.5); 2.5090 (24.6); 2.5046 (31.1); 2.5002
(22.7); 1.2412 (1.0); −0.0002 (1.0)
I-096: ¹H-NMR(300.2 MHz, CDCl3):
δ = 7.9961 (5.0); 7.9874 (5.1); 7.8491 (5.0); 7.8435 (5.1); 7.6422 (0.4); 7.6158 (3.1); 7.6105 (2.8);
7.6057 (2.8); 7.5979 (7.6); 7.5949 (7.2); 7.4827 (3.9); 7.4627 (1.7); 7.4506 (2.1); 7.4437 (1.7); 7.4324
(1.5); 7.4244 (0.9); 7.3350 (3.4); 7.3048 (16.9); 7.0486 (4.1); 6.9415 (2.2); 6.9143 (2.0); 6.8446 (1.0);
6.8247 (1.8); 6.8039 (1.0); 6.6312 (3.4); 6.6249 (4.5); 6.6164 (3.2); 4.1403 (1.8); 4.1198 (1.7); 4.0918
(3.8); 4.0711 (3.6); 4.0431 (1.9); 4.0225 (1.8); 2.4671 (11.7); 2.3471 (0.5); 2.2917 (16.0); 1.6327
(11.0); 1.3108 (2.2); 0.9483 (0.8); 0.9267 (2.2); 0.9034 (0.9); 0.1151 (0.7); 0.0553 (0.6); 0.0446
(14.4); 0.0338 (0.5)
I-097: ¹H-NMR(400.0 MHz, d₆-DMSO):
δ = 9.0618 (2.2); 9.0441 (2.2); 8.1378 (10.9); 7.7311 (0.8); 7.7120 (2.7); 7.6925 (3.0); 7.6803 (3.7);
7.6581 (4.7); 7.6404 (0.6); 7.5721 (2.3); 7.5522 (1.8); 7.4422 (4.2); 7.3385 (2.0); 7.3345 (1.8); 7.3183
(2.6); 7.3145 (2.5); 7.2073 (3.6); 7.1872 (2.7); 4.6964 (0.7); 4.6835 (1.4); 4.6650 (1.5); 4.6518 (0.8);
3.3217 (17.8); 3.3087 (1.5); 3.2861 (1.7); 3.2682 (2.7); 3.2501 (1.4); 3.2281 (1.7); 3.2097 (1.5);
2.9322 (1.5); 2.9198 (1.5); 2.8910 (1.3); 2.8762 (2.3); 2.8620 (1.6); 2.8336 (1.3); 2.8211 (1.3); 2.6711
(0.5); 2.5060 (70.2); 2.5017 (90.4); 2.4974 (65.2); 2.3330 (0.4); 2.3285 (0.5); 1.3973
(16.0); −0.0002 (8.0)
I-098: ¹H-NMR(400.0 MHz, d₆-DMSO):
δ = 9.2571 (1.3); 9.2379 (1.3); 7.8122 (6.2); 7.7250 (0.6); 7.7058 (1.7); 7.6859 (1.5); 7.6590 (1.3);
7.6446 (2.7); 7.6371 (7.3); 7.6280 (8.9); 7.6064 (1.2); 7.5729 (1.4); 7.5513 (1.0); 5.2151 (0.8); 5.1969
(1.3); 5.1789 (0.8); 3.3912 (80.6); 2.8944 (1.0); 2.7361 (0.9); 2.6170 (16.0); 2.5312 (0.3); 2.5180
(6.5); 2.5137 (13.5); 2.5092 (18.0); 2.5047 (13.0); 2.5004 (6.3); 1.4705 (6.3); 1.4529 (6.2)
I-099: ¹H-NMR(400.0 MHz, CD3CN):
δ = 8.2376 (7.4); 8.1332 (2.0); 8.0852 (16.0); 8.0124 (0.4); 7.7135 (1.3); 7.6937 (5.2); 7.6763 (14.2);
7.6611 (1.4); 7.6227 (2.4); 7.6026 (6.2); 7.5817 (10.2); 7.5616 (3.7); 7.5094 (7.4); 7.4747 (0.4);
7.4543 (4.4); 7.4372 (3.4); 4.3735 (3.8); 4.3577 (3.9); 4.3397 (8.0); 4.3239 (7.8); 4.3060 (4.1); 4.2902
(3.9); 2.3860 (0.6); 2.2210 (32.4); 2.1301 (7.2); 1.9512 (16.2); 1.9452 (28.6); 1.9391 (37.7); 1.9330
(26.6); 1.9269 (14.0); 1.2846 (0.4); 1.2684 (1.0); 0.1460 (0.4); −0.0002 (80.7); −0.1497 (0.4)
I-100: ¹H-NMR(400.1 MHz, CDCl3):
δ = 8.0114 (2.3); 7.6271 (0.6); 7.6161 (0.4); 7.5971 (1.8); 7.5852 (2.6); 7.5429 (0.3); 7.4915 (0.4);
7.4717 (2.1); 7.4501 (3.9); 7.4050 (3.8); 7.3838 (2.1); 7.3608 (1.1); 7.3453 (0.7); 7.3403 (0.7); 7.2784
(0.7); 7.2604 (25.4); 4.1834 (0.7); 4.1683 (0.7); 4.1477 (1.4); 4.1327 (1.4); 4.1120 (0.8); 4.0972 (0.8);
2.9550 (16.0); 2.8800 (14.9); 1.5752 (1.2); 1.5031 (0.6); −0.0002 (7.3)
I-101: ¹H-NMR(300.2 MHz, CDCl3):
δ = 8.1350 (5.2); 8.0915 (0.5); 8.0738 (0.8); 8.0544 (0.5); 7.6381 (0.7); 7.6119 (1.8); 7.5855 (1.3);
7.5176 (3.9); 7.4888 (4.9); 7.4202 (4.2); 7.3978 (2.4); 7.3929 (2.5); 7.3678 (1.1); 7.3649 (1.2); 7.3412
(0.9); 7.3381 (1.0); 7.3342 (0.8); 7.3042 (3.0); 6.9240 (1.1); 6.7363 (2.3); 6.5487 (1.2); 4.2744 (1.1);
4.2542 (1.1); 4.2273 (2.3); 4.2070 (2.2); 4.1802 (1.2); 4.1599 (1.1); 2.7630 (16.0); 1.6462 (0.5);
1.2986 (1.1); 0.0416 (2.9)
I-102: ¹H-NMR(400.2 MHz, d₆-DMSO):
δ = 9.1299 (1.5); 9.1090 (1.5); 7.9529 (1.4); 7.9032 (6.4); 7.7318 (0.6); 7.7121 (1.6); 7.6930 (1.4);
7.6542 (1.8); 7.6335 (3.2); 7.5967 (1.3); 7.5746 (1.0); 7.2780 (1.9); 7.2534 (2.0); 6.9939 (3.0); 6.9777
(3.0); 5.2970 (0.4); 5.2785 (0.5); 5.2692 (0.5); 5.2600 (0.5); 5.2503 (0.5); 5.2320 (0.4); 3.3299 (38.6);
2.8928 (10.3); 2.7336 (8.9); 2.6292 (16.0); 2.5260 (0.6); 2.5212 (1.0); 2.5126 (13.9); 2.5082 (28.3);
2.5037 (37.1); 2.4991 (26.6); 2.4946 (12.8); 2.1696 (0.8); 2.1538 (0.9); 2.1363 (1.1); 2.1207 (1.0);
1.8413 (0.9); 1.8123 (1.1); 1.7797 (0.8); 1.3882 (10.6); 1.2957 (10.4); 1.2404 (0.8)
I-103: ¹H-NMR(400.1 MHz, CDCl3):
δ = 8.2346 (6.4); 8.1430 (0.9); 7.3331 (2.1); 7.3131 (2.4); 7.2602 (9.2); 7.1428 (2.0); 7.1230 (2.5);
7.0342 (2.5); 6.9938 (1.6); 6.9888 (1.7); 6.9741 (1.3); 6.9690 (1.5); 6.9590 (1.4); 6.9389 (1.3); 6.9150
(2.8); 6.9108 (2.4); 4.2337 (1.0); 4.2188 (1.0); 4.1976 (2.2); 4.1827 (2.2); 4.1614 (1.2); 4.1465 (1.1);
3.2133 (16.0); 2.9563 (2.3); 2.8838 (2.1); 2.4694 (7.1); 2.2947 (10.0); 1.5623 (6.1); −0.0002 (2.6)
I-104: ¹H-NMR(400.1 MHz, CDCl3):
δ = 8.2664 (0.3); 7.9976 (1.5); 7.5582 (1.5); 7.5385 (6.2); 7.5226 (16.0); 7.5051 (11.0); 7.4834 (14.0);
7.4552 (0.6); 7.4337 (0.8); 7.4056 (8.0); 7.3842 (13.4); 7.3628 (9.9); 7.3508 (3.4); 7.3441 (5.2);
7.3387 (3.6); 7.3336 (2.4); 7.3275 (3.6); 7.3222 (2.3); 7.2599 (117.9); 6.9960 (0.6); 6.3158 (2.0);
6.3002 (3.5); 6.2852 (1.9); 4.2229 (3.6); 4.2073 (3.6); 4.1863 (7.8); 4.1707 (7.4); 4.1497 (4.0); 4.1341
(3.7); 4.0036 (2.7); 2.9511 (11.2); 2.8722 (10.0); 1.9601 (1.1); 1.9454 (2.5); 1.9383 (2.5); 1.9308
(1.7); 1.9237 (4.9); 1.9167 (1.7); 1.9090 (2.7); 1.9020 (2.7); 1.8873 (1.3); 1.5433 (160.8); 1.5032
(0.6); 1.2722 (0.4); 1.2653 (0.4); 1.2596 (0.5); 1.2530 (0.6); 1.1783 (0.3); 1.1645 (2.2); 1.1504 (6.7);
1.1480 (7.6); 1.1446 (5.4); 1.1345 (3.9); 1.1291 (7.3); 1.1264 (7.1); 1.1133 (2.9); 1.0980 (0.5); 1.0922
(0.4); 1.0828 (0.5); 1.0765 (0.7); 1.0628 (0.4); 1.0560 (0.4); 0.9851 (0.4); 0.9695 (0.4); 0.9474 (3.0);
0.9324 (9.2); 0.9178 (8.6); 0.9040 (2.0); 0.7916 (0.4); 0.7794 (0.4); 0.0079 (1.6); −0.0002
(34.5); −0.0084 (1.8)
I-105: ¹H-NMR(300.2 MHz, CDCl3):
δ = 8.1263 (0.3); 7.7723 (0.4); 7.7604 (3.0); 7.6086 (0.6); 7.5835 (1.4); 7.5783 (1.8); 7.5736 (1.9);
7.4891 (0.8); 7.4370 (0.4); 7.4308 (0.6); 7.4238 (0.4); 7.4096 (0.6); 7.4055 (0.6); 7.3823 (1.2); 7.3768
(1.3); 7.3676 (1.7); 7.3400 (0.3); 7.2986 (5.6); 3.8095 (0.3); 3.2100 (16.0); 0.1065 (0.6); 0.0364 (4.4)
I-106: ¹H-NMR(300.2 MHz, CDCl3):
δ = 8.9558 (2.5); 8.9494 (2.6); 7.9244 (2.7); 7.9180 (2.6); 7.5996 (1.0); 7.5785 (3.2); 7.5157 (1.5);
7.4831 (0.7); 7.4741 (1.1); 7.4669 (0.7); 7.4603 (0.4); 7.4518 (0.6); 7.4451 (0.4); 7.2988 (14.9);
7.2761 (1.6); 7.0473 (1.6); 6.9634 (0.8); 6.9365 (0.7); 6.5245 (0.4); 6.5045 (0.7); 6.4841 (0.4); 5.3381
(0.3); 4.1064 (0.7); 4.0857 (0.7); 4.0570 (1.6); 4.0363 (1.5); 4.0075 (0.8); 3.9869 (0.8); 2.4480 (4.6);
2.4408 (2.6); 2.3000 (6.2); 2.2757 (0.3); 1.6109 (16.0); 0.0487 (0.5); 0.0378 (13.2); 0.0268 (0.5)
I-107: ¹H-NMR(400.2 MHz, d₆-DMSO):
δ = 9.1235 (1.4); 9.1030 (1.4); 7.8225 (6.6); 7.7165 (0.5); 7.6963 (1.6); 7.6775 (1.3); 7.6363 (1.8);
7.6185 (3.5); 7.5731 (1.3); 7.5511 (1.1); 7.1053 (1.4); 7.0872 (1.5); 7.0324 (1.3); 7.0144 (1.5); 6.7283
(1.6); 6.7095 (2.7); 6.6908 (1.3); 5.2492 (0.4); 5.2339 (0.9); 5.2148 (0.9); 5.1994 (0.4); 4.2834 (0.9);
4.2748 (0.8); 4.2655 (1.2); 4.2541 (1.2); 4.2430 (0.8); 4.2346 (1.0); 4.2150 (0.3); 3.3329 (33.2);
2.6052 (16.0); 2.5250 (0.5); 2.5203 (0.7); 2.5116 (9.0); 2.5072 (18.5); 2.5027 (24.4); 2.4981 (17.7);
2.4937 (8.6); 2.1630 (0.4); 2.1600 (0.4); 2.1481 (0.5); 2.1397 (0.6); 2.1339 (0.5); 2.1279 (0.6); 2.1146
(0.7); 2.1029 (12.0); 2.0125 (0.4); 2.0034 (0.6); 1.9956 (0.7); 1.9864 (0.5); 1.9780 (0.6); 1.9693 (0.4);
1.9610 (0.4); 1.2406 (0.4)
I-108: ¹H-NMR(400.2 MHz, d₆-DMSO):
δ = 9.1047 (1.5); 9.0894 (3.0); 9.0734 (1.4); 8.7025 (4.9); 8.6969 (4.8); 8.3163 (0.5); 8.0824 (16.0);
7.9229 (3.0); 7.9169 (3.0); 7.9018 (3.8); 7.8958 (3.7); 7.7473 (1.1); 7.7281 (3.6); 7.7100 (8.9); 7.6969
(4.8); 7.6903 (6.0); 7.6773 (1.6); 7.6163 (4.8); 7.5487 (2.7); 7.5291 (2.1); 4.2781 (1.5); 4.2625 (1.5);
4.2428 (3.4); 4.2270 (3.3); 4.2071 (1.7); 4.1915 (1.6); 3.9028 (0.8); 3.3274 (168.0); 2.6758 (1.3);
2.6713 (1.8); 2.6667 (1.3); 2.5415 (1.3); 2.5246 (7.2); 2.5112 (122.4); 2.5068 (235.1); 2.5023 (298.1);
2.4978 (213.9); 2.4934 (104.7); 2.3336 (1.3); 2.3291 (1.8); 2.3247 (1.3); 1.2357 (0.4); −0.0002 (1.3)
I-109: ¹H-NMR(300.2 MHz, CDCl3):
δ = 8.2829 (9.4); 7.6427 (0.9); 7.6167 (2.4); 7.5997 (1.9); 7.5736 (2.2); 7.5475 (0.8); 7.3016 (14.6);
7.2108 (0.8); 7.1949 (0.8); 7.1468 (2.5); 7.0389 (1.4); 7.0214 (2.7); 7.0132 (1.5); 6.9966 (2.7); 6.7785
(1.6); 6.7527 (1.4); 6.7064 (2.9); 3.6600 (0.5); 3.6468 (0.6); 3.6413 (0.6); 3.6353 (0.8); 3.6281 (0.7);
3.6201 (0.9); 3.6171 (0.9); 3.6097 (0.7); 3.6022 (0.8); 3.5963 (0.6); 3.5910 (0.6); 3.5777 (0.4); 2.4036
(0.5); 2.3752 (1.5); 2.3501 (1.5); 2.3336 (16.0); 2.0495 (0.5); 1.9991 (14.8); 1.5986 (7.0); 1.5716
(1.0); 1.5506 (1.4); 1.5418 (1.0); 1.5270 (1.2); 1.5208 (1.3); 1.5182 (1.2); 1.4972 (0.9); 1.2027 (0.9);
1.1897 (1.0); 1.1806 (1.4); 1.1674 (1.3); 1.1587 (0.9); 1.1457 (0.8); 0.0512 (0.5); 0.0403 (14.6);
0.0294 (0.5)
I-110: ¹H-NMR(400.1 MHz, d₆-DMSO):
δ = 9.2787 (1.2); 9.2633 (2.7); 9.2476 (1.4); 7.8781 (6.6); 7.8031 (0.8); 7.7839 (2.4); 7.7632 (2.3);
7.7422 (3.6); 7.7228 (1.7); 7.6010 (7.8); 7.5846 (2.3); 7.3860 (4.2); 7.3829 (6.7); 7.3797 (4.2); 7.1959
(3.5); 7.1759 (4.1); 7.1641 (6.3); 7.0439 (4.4); 6.8587 (2.4); 6.8393 (2.2); 5.7502 (9.8); 4.0205 (1.2);
4.0043 (1.2); 3.9831 (2.6); 3.9675 (2.5); 3.9458 (1.4); 3.9302 (1.3); 3.3007 (32.3); 2.5043 (13.8);
2.4999 (18.8); 2.4955 (14.1); 2.3428 (11.6); 2.1972 (16.0); 2.1618 (0.4); 1.9872 (0.4); 1.2358 (0.5);
1.1748 (0.3); 0.0080 (0.4); −0.0002 (11.4)
I-111: ¹H-NMR(300.2 MHz, CDCl3):
δ = 8.1076 (0.4); 7.7211 (3.1); 7.5944 (0.7); 7.5694 (1.7); 7.4914 (1.1); 7.4624 (2.6); 7.4006 (2.3);
7.3732 (1.2); 7.2983 (1.2); 4.2537 (0.5); 4.2334 (0.5); 4.2069 (1.0); 4.1866 (1.0); 4.1600 (0.5); 4.1398
(0.5); 3.2051 (16.0); 3.0767 (0.5); 0.0339 (1.0)
I-112: ¹H-NMR(400.2 MHz, d₆-DMSO):
δ = 9.0776 (0.7); 9.0620 (1.4); 9.0458 (0.7); 8.3097 (3.3); 7.8519 (0.3); 7.7379 (0.6); 7.7187 (1.8);
7.6990 (1.6); 7.6821 (0.4); 7.6693 (1.9); 7.6581 (6.4); 7.6502 (1.3); 7.5865 (2.4); 7.5447 (0.3); 7.5312
(1.4); 7.5152 (3.1); 7.4948 (2.5); 7.4304 (2.7); 7.1159 (1.3); 7.0957 (1.2); 4.2724 (0.6); 4.2577 (0.7);
4.2378 (1.4); 4.2221 (1.4); 4.2025 (0.7); 4.1871 (0.7); 3.9296 (1.2); 3.9240 (1.4); 3.9049 (1.3); 3.8970
(1.8); 3.4101 (1.4); 3.4011 (1.3); 3.3823 (2.4); 3.3744 (2.4); 3.3239 (957.9); 2.7594 (0.4); 2.7442
(0.6); 2.7326 (0.8); 2.7117 (1.0); 2.6899 (1.1); 2.6805 (1.6); 2.6760 (3.2); 2.6714 (4.4); 2.6668 (3.1);
2.6623 (1.5); 2.6279 (0.3); 2.5912 (2.3); 2.5799 (16.0); 2.5416 (166.2); 2.5248 (13.7); 2.5200 (20.7);
2.5114 (264.0); 2.5070 (519.0); 2.5024 (672.3); 2.4979 (482.6); 2.4934 (231.0); 2.3683 (0.6); 2.3384
(1.4); 2.3338 (3.1); 2.3293 (4.2); 2.3248 (3.0); 2.3203 (1.4); 2.2950 (1.1); 1.5955 (2.1); 1.5878 (2.2);
1.5732 (3.0); 1.5633 (2.0); 1.5455 (0.7); 1.5347 (0.8); 1.2601 (0.4); 1.2460 (0.5); 1.2352
(0.5); −0.0002 (6.2)
I-113: ¹H-NMR(400.0 MHz, CD3CN):
δ = 8.3305 (6.6); 8.3262 (7.3); 8.1733 (1.9); 8.1489 (7.7); 8.1445 (7.6); 8.0917 (16.0); 8.0076 (0.4);
7.7130 (1.2); 7.6933 (4.5); 7.6751 (12.4); 7.6578 (1.3); 7.5175 (6.2); 7.4795 (0.3); 7.4632 (2.3);
7.4579 (4.0); 7.4530 (2.5); 7.4403 (2.9); 5.4456 (0.4); 4.4402 (3.4); 4.4239 (3.5); 4.4072 (7.2); 4.3909
(7.1); 4.3742 (3.7); 4.3579 (3.6); 4.0854 (0.3); 4.0677 (1.0); 4.0498 (1.0); 4.0320 (0.3); 2.1297 (19.9);
2.1068 (0.3); 1.9713 (4.3); 1.9636 (1.5); 1.9575 (3.5); 1.9517 (18.3); 1.9455 (33.3); 1.9394 (44.8);
1.9332 (31.4); 1.9271 (16.6); 1.2676 (0.7); 1.2215 (1.1); 1.2037 (2.2); 1.1859 (1.1); 0.1457 (0.5);
0.0077 (4.3); −0.0002 (104.0); −0.0083 (5.3); −0.1499 (0.5)
I-114: ¹H-NMR(300.2 MHz, CDCl3):
δ = 7.5875 (0.5); 7.5613 (3.0); 7.5536 (2.7); 7.5488 (3.0); 7.5426 (7.8); 7.5394 (7.6); 7.4580 (3.6);
7.4349 (0.6); 7.4282 (0.5); 7.4196 (1.6); 7.4084 (2.4); 7.3982 (4.6); 7.3894 (1.9); 7.3806 (1.2); 7.3715
(4.1); 7.2986 (12.4); 7.0848 (4.0); 7.0045 (2.2); 6.9782 (1.9); 6.5072 (1.0); 6.4873 (1.9); 6.4672 (1.0);
4.2891 (1.8); 4.2687 (1.8); 4.2394 (3.9); 4.2190 (3.7); 4.1897 (2.0); 4.1693 (1.9); 2.5186 (12.0);
2.5119 (6.9); 2.3567 (0.4); 2.3218 (16.0); 2.0392 (1.0); 1.9886 (0.6); 1.9689 (1.2); 1.9595 (1.2);
1.9495 (0.8); 1.9401 (2.5); 1.9308 (0.8); 1.9204 (1.3); 1.9111 (1.4); 1.8916 (0.7); 1.6081 (12.4);
1.4517 (0.6); 1.4307 (0.6); 1.2927 (5.1); 1.2177 (0.3); 1.1934 (1.2); 1.1766 (3.2); 1.1705 (3.9); 1.1658
(2.9); 1.1532 (2.0); 1.1469 (3.4); 1.1421 (3.4); 1.1249 (1.6); 1.1044 (0.4); 0.9935 (1.7); 0.9739 (4.4);
0.9545 (4.2); 0.9355 (1.2); 0.9179 (0.5); 0.9091 (0.4); 0.8942 (0.5); 0.8676 (0.3); 0.0483 (0.4); 0.0376
(11.4); 0.0266 (0.5)
I-115: ¹H-NMR(300.2 MHz, CDCl3):
δ = 7.5944 (0.4); 7.5656 (4.4); 7.5605 (3.3); 7.5483 (7.4); 7.4517 (3.8); 7.4247 (0.6); 7.4110 (1.7);
7.3908 (5.2); 7.3818 (1.8); 7.3641 (4.3); 7.2986 (8.7); 7.1072 (4.2); 7.0352 (2.3); 7.0087 (1.9); 6.8275
(1.0); 6.8070 (1.9); 6.7866 (1.0); 5.3988 (0.6); 5.3819 (1.7); 5.3627 (2.9); 5.3459 (2.0); 5.3270 (0.7);
4.8806 (1.6); 4.8531 (6.9); 4.8361 (9.2); 4.8224 (6.7); 4.8120 (1.9); 4.7955 (1.1); 4.2476 (1.6); 4.2269
(1.6); 4.1983 (3.4); 4.1776 (3.4); 4.1539 (1.2); 4.1489 (1.8); 4.1290 (1.8); 2.9674 (0.4); 2.8545 (0.3);
2.5190 (11.8); 2.5125 (7.1); 2.3724 (0.8); 2.3460 (16.0); 2.3052 (0.3); 2.0727 (2.5); 1.3150 (0.9);
1.2916 (2.8); 1.2674 (0.9); 0.3055 (0.4); 0.1938 (0.5); 0.1760 (1.1); 0.1223 (4.6); 0.1104 (100.1);
0.0982 (4.9); 0.0385 (7.4); 0.0276 (0.4); −0.0876 (0.4)
I-116: ¹H-NMR(400.2 MHz, d₆-DMSO):
δ = 9.0741 (1.4); 9.0547 (1.4); 7.7418 (0.6); 7.7204 (7.1); 7.7025 (1.5); 7.6826 (1.8); 7.6628 (0.8);
7.6192 (2.1); 7.5188 (1.1); 7.4988 (0.9); 7.2622 (3.4); 7.2412 (4.2); 7.0720 (0.5); 7.0656 (4.6); 7.0610
(1.5); 7.0446 (3.8); 5.7574 (0.3); 4.7742 (0.5); 4.7624 (0.6); 4.7545 (0.6); 4.7498 (0.7); 4.7431 (0.7);
4.7382 (0.6); 4.7302 (0.6); 4.7185 (0.5); 3.6840 (16.0); 3.3323 (111.8); 3.3055 (0.3); 3.1983 (0.7);
3.1865 (0.7); 3.1635 (1.0); 3.1519 (0.9); 3.0322 (1.0); 3.0075 (1.0); 2.9975 (0.8); 2.9730 (0.7); 2.6710
(0.3); 2.5969 (14.7); 2.5245 (0.9); 2.5111 (20.8); 2.5067 (42.9); 2.5022 (56.8); 2.4977 (41.3); 2.4932
(20.3); 2.3289 (0.3); −0.0002 (0.4)
I-117: ¹H-NMR(400.0 MHz, d₆-DMSO):
δ = 9.0548 (1.5); 9.0345 (1.5); 7.7689 (5.9); 7.7295 (0.7); 7.7096 (1.9); 7.6904 (1.5); 7.6566 (4.3);
7.6359 (1.1); 7.5817 (1.5); 7.5621 (1.1); 7.0772 (1.4); 7.0550 (3.9); 6.9489 (2.3); 6.9297 (1.7); 5.0681
(0.8); 5.0496 (1.2); 5.0313 (0.8); 3.3537 (40.0); 3.3502 (40.8); 2.8903 (2.0); 2.7316 (1.8); 2.6495
(1.3); 2.6362 (2.6); 2.6209 (1.5); 2.6009 (16.0); 2.5735 (0.4); 2.5462 (0.6); 2.5259 (1.6); 2.5118 (9.8);
2.5077 (19.0); 2.5032 (25.0); 2.4988 (18.5); 2.4945 (9.5); 2.4686 (0.3); 1.6631 (3.4); 1.6558 (2.9);
1.6483 (3.4); 1.6188 (0.5); 1.4062 (6.2); 1.3887 (6.2); 1.2402 (0.4)
I-118: ¹H-NMR(400.2 MHz, d₆-DMSO):
δ = 9.2244 (1.5); 9.2035 (1.5); 7.9224 (0.4); 7.8490 (6.6); 7.7213 (0.6); 7.7010 (1.7); 7.6805 (1.4);
7.6548 (0.4); 7.6413 (2.0); 7.6256 (3.2); 7.6235 (3.2); 7.5871 (1.4); 7.5649 (1.1); 7.1938 (1.1); 7.1868
(1.2); 7.1667 (2.0); 7.1627 (1.4); 7.1524 (1.4); 7.1445 (1.8); 7.1306 (1.7); 7.0451 (0.9); 7.0380 (0.8);
7.0241 (1.4); 7.0170 (1.2); 7.0026 (0.6); 6.9955 (0.6); 5.2416 (0.4); 5.2220 (0.8); 5.2103 (0.8); 5.2028
(0.6); 5.1908 (0.4); 3.3376 (58.8); 3.1596 (0.3); 3.1497 (0.4); 3.1376 (0.9); 3.1277 (0.8); 3.1179 (0.8);
3.1074 (0.7); 3.0969 (0.7); 3.0869 (0.8); 3.0768 (0.8); 3.0670 (0.9); 3.0552 (0.4); 3.0448 (0.3); 2.6323
(1.2); 2.6140 (16.0); 2.5257 (0.6); 2.5210 (0.8); 2.5121 (10.9); 2.5078 (22.2); 2.5033 (29.4); 2.4988
(21.5); 2.4944 (10.6); 2.2080 (0.6); 2.1971 (0.8); 2.1872 (0.8); 2.1774 (1.0); 2.1672 (0.8); 2.1576
(0.8); 2.1477 (0.8); 2.1383 (0.4); 2.1285 (0.5); 1.2398 (0.4)
I-119: ¹H-NMR(499.9 MHz, CDCl3):
δ = 7.5359 (0.3); 7.5190 (3.0); 7.5092 (4.4); 7.4104 (2.4); 7.3383 (0.8); 7.3302 (1.2); 7.3271 (1.1);
7.3209 (0.9); 7.2579 (2.9); 7.0067 (1.9); 6.9915 (2.5); 6.9464 (2.9); 6.8477 (1.6); 6.8324 (1.3); 6.3986
(1.0); 4.1142 (0.9); 4.0484 (16.0); 3.7468 (1.1); 3.7335 (2.9); 3.7207 (3.0); 3.7073 (1.1); 2.9127 (2.0);
2.8988 (3.9); 2.8851 (1.9); 2.3115 (0.9); 2.2892 (0.9); 2.2844 (0.8); 2.2715 (12.9); 2.2470 (12.0);
2.1884 (0.4); 1.5738 (1.9); 1.2559 (0.9); −0.0002 (2.5)
I-120: ¹H-NMR(300.2 MHz, CDCl3):
δ = 7.5382 (3.3); 7.5340 (2.3); 7.5245 (4.9); 7.5211 (5.8); 7.4283 (3.5); 7.4154 (1.5); 7.4065 (1.1);
7.4009 (1.9); 7.3943 (1.3); 7.3851 (1.0); 7.3769 (0.7); 7.3240 (4.0); 7.2985 (12.6); 7.1766 (4.8);
7.1503 (3.4); 6.4488 (1.3); 6.4220 (1.4); 5.4046 (1.1); 5.3802 (1.4); 5.3555 (1.1); 2.3627 (16.0);
2.3218 (0.4); 1.9456 (0.4); 1.9259 (1.0); 1.9167 (1.0); 1.9065 (0.7); 1.8970 (1.9); 1.8886 (0.6); 1.8775
(1.1); 1.8682 (1.1); 1.8486 (0.6); 1.6565 (9.7); 1.6334 (10.5); 1.6237 (4.3); 1.5908 (0.5); 1.1428 (0.7);
1.1366 (0.7); 1.1200 (0.8); 1.1140 (1.1); 1.1072 (1.5); 1.1018 (1.0); 1.0909 (0.8); 1.0868 (0.7); 1.0779
(1.0); 1.0724 (0.9); 1.0654 (1.0); 1.0559 (1.0); 1.0520 (0.9); 1.0409 (1.0); 1.0371 (1.0); 1.0271 (1.2);
1.0235 (1.5); 1.0123 (0.8); 0.9960 (0.6); 0.9875 (0.5); 0.9824 (0.7); 0.9732 (0.5); 0.9602 (0.8); 0.9527
(1.6); 0.9421 (3.7); 0.9330 (2.4); 0.9226 (3.6); 0.9162 (1.6); 0.9124 (1.2); 0.9079 (1.0); 0.0375 (6.6)
I-121: ¹H-NMR(400.1 MHz, d₆-DMSO):
δ = 9.3205 (1.3); 9.3049 (2.7); 9.2892 (1.3); 8.3005 (1.8); 8.2811 (3.7); 8.2612 (2.2); 8.0755 (14.7);
7.9528 (2.4); 7.8805 (5.0); 7.8618 (4.6); 7.8157 (0.7); 7.8071 (0.6); 7.7866 (0.5); 7.7368 (4.6); 7.7321
(4.8); 7.6975 (0.6); 7.6790 (0.5); 7.6658 (0.9); 7.6557 (0.4); 7.5822 (4.4); 7.5704 (4.6); 7.5615 (4.4);
7.5490 (5.3); 7.5354 (0.4); 7.5140 (1.0); 7.5001 (0.6); 7.4956 (0.5); 7.3016 (2.7); 7.2966 (2.8); 7.2805
(2.4); 7.2754 (2.4); 5.0320 (0.4); 4.2118 (1.3); 4.1958 (1.4); 4.1770 (3.0); 4.1612 (2.9); 4.1419 (1.5);
4.1263 (1.4); 3.3014 (32.4); 2.8907 (16.0); 2.7315 (14.0); 2.5094 (7.5); 2.5053 (15.4); 2.5008 (21.1);
2.4964 (15.4); 0.0079 (0.4); −0.0002 (9.7); −0.0083 (0.4)
I-122: ¹H-NMR(400.1 MHz, d₆-DMSO):
δ = 9.1030 (1.8); 9.0875 (3.8); 9.0719 (1.8); 7.9609 (2.6); 7.8644 (7.1); 7.6340 (2.1); 7.6142 (5.0);
7.5945 (3.3); 7.5549 (15.0); 7.4960 (8.0); 7.4750 (11.5); 7.4441 (5.1); 7.4402 (5.0); 7.4231 (2.4);
7.4190 (2.5); 7.3829 (6.0); 7.3434 (3.4); 7.3232 (2.9); 7.2296 (2.8); 7.0903 (6.1); 6.9511 (3.0); 4.2765
(1.7); 4.2609 (1.9); 4.2420 (3.8); 4.2265 (3.7); 4.2076 (2.0); 4.1919 (1.8); 3.3117 (31.6); 2.8985
(16.0); 2.7397 (14.5); 2.5129 (14.0); 2.5087 (18.6); 2.5045 (14.0); 2.3118 (0.7); 2.2996 (1.6); 2.2909
(1.8); 2.2789 (3.2); 2.2669 (2.0); 2.2585 (1.7); 2.2463 (0.9); 1.0960 (1.4); 1.0846 (4.0); 1.0781 (5.8);
1.0693 (3.7); 1.0640 (4.1); 1.0577 (5.2); 1.0493 (2.4); 1.0332 (0.8); 1.0202 (0.6); 1.0134 (0.6); 0.9965
(2.4); 0.9879 (5.8); 0.9824 (5.7); 0.9763 (6.3); 0.9701 (5.2); 0.9584 (1.6)
I-123: ¹H-NMR(400.0 MHz, d₆-DMSO):
δ = 9.0619 (1.9); 7.9539 (0.8); 7.8006 (4.9); 7.7519 (2.8); 7.7475 (1.5); 7.7306 (4.6); 7.7071 (1.0);
7.6621 (3.1); 7.6458 (4.6); 7.6288 (1.0); 7.6244 (2.7); 7.5991 (1.0); 7.5810 (0.7); 3.3721 (23.4);
3.3642 (38.9); 2.8927 (5.7); 2.7340 (4.8); 2.6448 (0.6); 2.6194 (12.1); 2.5149 (5.8); 2.5105 (12.3);
2.5060 (16.6); 2.5014 (11.9); 2.4970 (5.8); 1.6319 (16.0); 1.2996 (0.4)
I-124: ¹H-NMR(300.2 MHz, CDCl3):
δ = 7.5861 (3.7); 7.5823 (3.8); 7.5786 (2.9); 7.5712 (2.4); 7.5455 (3.5); 7.5196 (2.1); 7.5000 (0.6);
7.4949 (0.6); 7.4016 (8.2); 7.3980 (7.9); 7.3626 (1.4); 7.3352 (1.9); 7.3060 (3.7); 7.2985 (11.5);
7.2934 (4.4); 7.2012 (0.4); 7.1953 (0.5); 7.1854 (0.5); 6.4393 (1.3); 6.0962 (0.8); 6.0857 (0.9); 6.0803
(0.6); 6.0737 (0.9); 6.0631 (0.7); 5.9413 (0.8); 5.9306 (0.8); 5.9247 (0.6); 5.9187 (0.9); 5.9079 (0.7);
4.2770 (0.4); 4.2660 (0.4); 4.2557 (0.4); 4.2447 (0.4); 4.2283 (0.5); 4.2176 (0.5); 4.2067 (0.6); 4.1957
(0.7); 4.1913 (0.8); 4.1791 (0.6); 4.1683 (1.3); 4.1629 (0.7); 4.1443 (1.3); 4.1308 (0.6); 4.1204 (0.8);
4.0035 (0.4); 3.9838 (0.6); 3.9612 (0.5); 3.9548 (0.5); 3.9292 (0.7); 3.9090 (0.8); 3.8862 (0.6); 3.8800
(0.6); 3.8606 (0.7); 3.8422 (0.5); 3.1032 (0.5); 2.6412 (15.4); 2.6363 (7.6); 2.6255 (2.5); 2.3421
(16.0); 2.3374 (7.4); 2.0801 (4.4); 2.0750 (1.8); 1.8674 (0.7); 1.3192 (1.2); 1.3140 (0.6); 1.2954 (2.6);
1.2904 (1.2); 1.2716 (1.2); 1.2666 (0.5); 0.0372 (12.3); 0.0321 (4.7)
I-125: ¹H-NMR(300.2 MHz, CDCl3):
δ = 8.3180 (14.0); 7.8980 (1.3); 7.5322 (1.6); 7.5226 (2.3); 7.5135 (1.7); 7.5038 (2.3); 7.4957 (1.1);
7.4823 (1.2); 7.4655 (1.6); 7.4531 (2.0); 7.4421 (1.2); 7.4065 (2.4); 7.3775 (6.3); 7.3516 (4.4); 7.3016
(22.6); 7.0918 (3.9); 7.0171 (2.2); 6.9906 (1.8); 5.3412 (1.8); 4.3071 (2.1); 4.2873 (2.0); 4.2586 (4.4);
4.2389 (4.2); 4.2101 (2.2); 4.1903 (2.1); 2.5221 (6.5); 2.5151 (11.8); 2.5077 (6.5); 2.3704 (0.5);
2.3394 (16.0); 1.5946 (9.9); 0.0512 (0.6); 0.0404 (18.1); 0.0295 (0.6)
I-126: ¹H-NMR(400.1 MHz, CDCl3):
δ = 7.9872 (1.1); 7.5531 (0.5); 7.5336 (2.2); 7.5177 (5.7); 7.4086 (2.9); 7.3646 (1.1); 7.3582 (1.9);
7.3528 (1.4); 7.3420 (1.3); 7.2596 (14.4); 7.0336 (2.4); 7.0145 (2.9); 6.9679 (3.2); 6.8670 (1.8);
6.8483 (1.4); 6.0100 (0.7); 5.9964 (1.3); 5.9819 (0.7); 3.7789 (1.4); 3.7618 (3.6); 3.7466 (3.6); 3.7296
(1.4); 2.9550 (2.9); 2.9480 (8.3); 2.9382 (4.9); 2.9209 (2.2); 2.8691 (6.9); 2.2999 (16.0); 2.2807 (1.3);
2.2542 (14.8); 2.1940 (0.5); 2.1584 (0.6); 1.9213 (0.4); 1.9068 (0.9); 1.8998 (0.9); 1.8922 (0.6);
1.8851 (1.8); 1.8782 (0.7); 1.8704 (1.0); 1.8634 (1.0); 1.8488 (0.5); 1.5549 (21.2); 1.1427 (0.8);
1.1262 (2.8); 1.1132 (1.5); 1.1078 (2.6); 1.1047 (2.5); 1.0919 (1.0); 0.9504 (1.1); 0.9353 (3.4); 0.9210
(3.1); 0.9071 (0.7); −0.0002 (4.2)
I-127: ¹H-NMR(499.9 MHz, d₆-DMSO):
δ = 13.2756 (0.4); 9.2965 (1.2); 9.2840 (2.5); 9.2715 (1.2); 8.2917 (1.7); 8.2759 (3.2); 8.2600 (1.9);
8.1212 (9.9); 8.1025 (0.4); 8.0865 (0.7); 8.0706 (0.4); 7.9536 (2.6); 7.8855 (1.0); 7.8734 (4.2); 7.8587
(4.1); 7.6947 (0.8); 7.6796 (0.8); 7.6482 (1.0); 7.6301 (0.4); 7.5995 (0.4); 7.5807 (3.7); 7.5640 (3.6);
7.5543 (5.2); 7.5373 (6.8); 7.5166 (7.2); 7.4394 (6.4); 7.4224 (4.9); 4.9358 (0.3); 4.9081 (0.7); 4.8801
(0.4); 4.0594 (1.2); 4.0468 (1.2); 4.0313 (2.6); 4.0188 (2.5); 4.0032 (1.3); 3.9907 (1.2); 3.3247 (25.0);
2.8909 (16.0); 2.7316 (14.3); 2.5055 (14.6); 2.5023 (18.7); 2.4990 (13.7); −0.0002 (5.8)
I-128: ¹H-NMR(300.2 MHz, CDCl3):
δ = 8.9035 (1.9); 8.8135 (1.8); 8.8051 (1.8); 8.1862 (5.2); 7.9331 (1.3); 7.9267 (1.9); 7.9202 (1.2);
7.8980 (0.5); 7.8803 (0.7); 7.8609 (0.4); 7.4736 (1.8); 7.4453 (4.5); 7.4400 (2.0); 7.3141 (1.7); 7.3071
(1.7); 7.2994 (6.7); 7.2862 (1.2); 7.2795 (1.1); 6.1404 (0.5); 6.1301 (0.5); 6.1153 (0.5); 6.1050 (0.5);
5.9844 (0.5); 5.9739 (0.5); 5.9592 (0.5); 5.9489 (0.5); 5.3367 (0.5); 4.3320 (0.4); 4.3215 (0.4); 4.3091
(0.3); 4.2985 (0.4); 4.2370 (0.4); 4.2265 (0.4); 4.2140 (0.4); 4.2035 (0.3); 3.8773 (0.4); 3.8607 (0.4);
3.8520 (0.4); 3.8354 (0.4); 3.8286 (0.4); 3.8110 (0.6); 3.8033 (0.4); 3.7938 (0.4); 3.7861 (0.6); 3.7686
(0.4); 3.7617 (0.3); 2.7864 (16.0); 2.7755 (0.8); 2.7415 (0.5); 2.0813 (0.6); 1.6346 (2.4); 1.2948 (0.4);
1.2897 (0.4); 0.0349 (5.7)
I-129: ¹H-NMR(400.0 MHz, d₆-DMSO):
δ = 9.0912 (1.1); 9.0711 (1.1); 7.9526 (0.5); 7.7893 (4.8); 7.7245 (0.5); 7.7043 (1.5); 7.6839 (1.3);
7.6470 (1.8); 7.6345 (2.4); 7.6314 (2.6); 7.5706 (1.2); 7.5497 (0.9); 7.2544 (1.1); 7.2495 (1.3); 7.2226
(1.1); 7.2176 (1.3); 7.1619 (0.8); 7.1401 (1.3); 7.1365 (1.3); 7.0812 (1.4); 7.0594 (2.1); 7.0378 (0.9);
5.1043 (0.7); 5.0859 (1.1); 5.0676 (0.7); 3.7899 (16.0); 3.4045 (20.1); 3.3939 (20.2); 3.3792 (59.0);
2.8919 (3.3); 2.7334 (2.9); 2.6069 (13.8); 2.5154 (5.6); 2.5110 (11.8); 2.5065 (16.0); 2.5020 (11.6);
2.4975 (5.6); 1.4194 (5.3); 1.4020 (5.3)
I-130: ¹H-NMR(300.2 MHz, CDCl3):
δ = 7.7715 (4.4); 7.6348 (5.9); 7.6004 (2.8); 7.5950 (2.7); 7.5904 (2.7); 7.5829 (6.1); 7.5800 (5.8);
7.4578 (3.8); 7.4434 (1.6); 7.4313 (1.8); 7.4243 (1.4); 7.4133 (1.3); 7.4053 (0.8); 7.3365 (2.8); 7.3098
(3.6); 7.2983 (13.5); 7.0445 (3.4); 6.9311 (1.9); 6.9043 (1.6); 6.8034 (0.9); 6.7840 (1.6); 6.7643 (0.9);
4.1545 (1.4); 4.1339 (1.4); 4.1060 (3.0); 4.0854 (2.9); 4.0574 (1.5); 4.0370 (1.4); 2.4706 (9.7); 2.3412
(0.4); 2.2863 (12.9); 2.2133 (16.0); 2.0431 (0.3); 1.6032 (5.4); 0.1086 (0.5); 0.0387 (16.1)
I-131: ¹H-NMR(400.1 MHz, CDCl3):
δ = 7.5676 (1.5); 7.5480 (6.4); 7.5325 (16.0); 7.5184 (1.8); 7.4845 (9.9); 7.4632 (14.5); 7.4260 (8.2);
7.3827 (14.7); 7.3610 (12.3); 7.3500 (3.9); 7.2596 (51.8); 6.6843 (4.6); 6.6549 (5.1); 6.6400 (5.4);
6.6105 (5.6); 6.2940 (2.1); 6.2790 (3.7); 6.2647 (2.0); 6.0283 (10.3); 5.9840 (9.0); 5.7952 (10.2);
5.7657 (9.5); 4.1719 (3.7); 4.1562 (3.7); 4.1360 (7.7); 4.1202 (7.3); 4.0999 (3.9); 4.0842 (3.7); 1.5402
(40.9); 1.3050 (0.7); 1.2654 (3.1); 0.8987 (1.5); 0.8821 (3.7); 0.8645 (1.6); −0.0002 (49.7)
I-132: ¹H-NMR(400.1 MHz, CDCl3):
δ = 8.2424 (16.0); 8.0141 (1.9); 7.5978 (1.7); 7.5782 (5.1); 7.5664 (3.8); 7.5469 (4.3); 7.5273 (1.5);
7.2597 (29.6); 7.1837 (6.3); 7.1036 (8.2); 7.0835 (4.2); 7.0699 (3.0); 7.0504 (2.8); 6.9828 (3.4);
6.9632 (6.5); 6.9438 (3.4); 6.8488 (3.4); 6.8291 (2.5); 3.4883 (0.8); 3.4767 (1.4); 3.4688 (1.6); 3.4576
(2.7); 3.4462 (1.7); 3.4385 (1.6); 3.4270 (0.9); 2.9530 (14.7); 2.8805 (13.3); 2.5035 (1.1); 2.4834
(2.6); 2.4639 (2.6); 2.4439 (1.2); 1.5522 (14.9); 1.5296 (3.1); 1.5249 (2.2); 1.5123 (2.2); 1.5075 (2.9);
1.4900 (1.7); 1.1968 (1.7); 1.1859 (1.9); 1.1799 (3.1); 1.1692 (3.1); 1.1633 (1.8); 1.1524 (1.5); 0.0080
(0.4); −0.0002 (12.4)
I-133: ¹H-NMR(300.2 MHz, CDCl3):
δ = 7.6229 (2.6); 7.6055 (3.6); 7.4812 (1.8); 7.4480 (0.8); 7.4393 (0.8); 7.4331 (1.1); 7.4265 (0.9);
7.4178 (0.7); 7.4096 (0.5); 7.3724 (1.7); 7.3458 (2.0); 7.2988 (2.5); 7.0966 (2.0); 7.0065 (1.1); 6.9803
(1.0); 6.6986 (0.5); 6.6781 (1.0); 6.6578 (0.5); 4.2905 (0.9); 4.2696 (0.8); 4.2421 (1.8); 4.2211 (1.7);
4.1936 (0.9); 4.1726 (0.9); 2.5240 (6.4); 2.5109 (16.0); 2.3332 (7.7); 1.6479 (2.6); 1.3044 (0.3);
1.2936 (0.4); 0.0378 (1.8)
I-134: ¹H-NMR(300.2 MHz, CDCl3):
δ = 7.5512 (0.8); 7.5291 (1.5); 7.5140 (1.8); 7.4909 (1.0); 7.3943 (2.0); 7.3678 (2.4); 7.3373 (1.1);
7.3097 (1.6); 7.2986 (4.3); 7.2833 (0.7); 7.0769 (2.6); 6.9867 (1.3); 6.9603 (1.2); 6.4945 (0.6); 6.4739
(1.0); 6.4535 (0.6); 4.2947 (1.1); 4.2737 (1.0); 4.2463 (2.3); 4.2253 (2.2); 4.1979 (1.2); 4.1867 (0.3);
4.1769 (1.1); 4.1631 (0.4); 4.1393 (0.4); 2.6180 (16.0); 2.5314 (7.2); 2.4366 (0.4); 2.4294 (0.3);
2.3531 (0.9); 2.3139 (9.8); 2.2875 (16.0); 2.2034 (0.3); 2.0759 (1.7); 1.3168 (0.4); 1.2931 (1.0);
1.2692 (0.4); 0.0377 (3.7)
I-135: ¹H-NMR(300.2 MHz, CDCl3):
δ = 8.3301 (9.1); 8.0361 (1.4); 7.4849 (1.6); 7.4581 (4.2); 7.4312 (3.4); 7.3810 (6.0); 7.3545 (5.3);
7.3308 (0.5); 7.2985 (16.4); 7.2762 (2.9); 7.2693 (4.7); 7.2627 (2.9); 7.1867 (2.4); 7.1827 (2.2);
7.1632 (1.9); 7.1599 (2.0); 7.1559 (1.9); 7.1146 (0.4); 7.0799 (4.2); 7.0019 (2.2); 6.9750 (1.9); 5.1589
(3.3); 5.1385 (4.9); 5.1308 (4.2); 5.1104 (5.2); 5.0412 (4.8); 5.0197 (7.5); 4.9986 (3.8); 4.7039 (0.7);
4.6813 (1.4); 4.6763 (1.3); 4.6534 (2.1); 4.6308 (1.1); 4.6257 (1.0); 4.6030 (0.4); 4.3135 (1.7); 4.2938
(1.7); 4.2655 (3.6); 4.2457 (3.5); 4.2174 (1.9); 4.1975 (1.9); 3.4198 (0.4); 3.3835 (0.6); 3.2934 (0.5);
2.5181 (11.4); 2.4414 (0.4); 2.3346 (16.0); 2.0428 (4.7); 1.6386 (0.7); 1.4971 (0.3); 1.4510 (0.6);
1.2937 (6.8); 1.1453 (1.3); 0.9587 (0.4); 0.9179 (1.0); 0.8937 (1.1); 0.8708 (0.7); 0.2087 (0.8); 0.1891
(1.3); 0.1084 (0.4); 0.0483 (0.6); 0.0376 (14.9)
I-136: ¹H-NMR(499.9 MHz, CDCl3):
δ = 7.5149 (1.0); 7.5010 (2.5); 7.4218 (1.3); 7.3785 (0.6); 7.3741 (0.9); 7.3698 (0.6); 7.3605 (0.7);
7.3561 (0.5); 7.3489 (1.2); 7.3329 (1.2); 7.2593 (2.2); 7.0358 (1.4); 6.9730 (0.8); 6.9572 (0.7); 6.8458
(0.4); 6.8338 (0.7); 6.8218 (0.4); 4.2642 (5.2); 4.1917 (0.5); 4.1792 (0.5); 4.1614 (1.1); 4.1490 (1.0);
4.1313 (0.6); 4.1188 (0.5); 3.2589 (9.2); 2.4699 (4.0); 2.2687 (5.4); 1.3010 (16.0); 1.2654 (0.7);
0.8819 (0.6); −0.0002 (2.8)
I-137: ¹H-NMR(300.2 MHz, CDCl3):
δ = 8.0105 (3.9); 8.0019 (3.9); 7.6562 (0.5); 7.6296 (3.3); 7.6231 (3.1); 7.6183 (3.3); 7.6116 (7.4);
7.6084 (7.7); 7.5237 (3.7); 7.5023 (0.6); 7.4872 (1.7); 7.4759 (2.2); 7.4692 (2.0); 7.4573 (1.5); 7.4496
(1.0); 7.3374 (3.5); 7.3105 (4.4); 7.2984 (18.7); 7.0590 (4.1); 6.9789 (2.3); 6.9462 (3.4); 6.8332 (4.0);
6.8245 (3.8); 6.7633 (4.5); 6.6170 (1.1); 6.5976 (1.9); 6.5809 (3.1); 4.1196 (1.9); 4.0989 (1.8); 4.0697
(3.9); 4.0491 (3.7); 4.0198 (2.0); 3.9993 (1.9); 2.4574 (11.9); 2.3511 (0.5); 2.3063 (16.0); 2.0429
(0.5); 1.5965 (7.4); 0.1089 (0.8); 0.0494 (1.4); 0.0389 (22.5); 0.0280 (1.2)
I-138: ¹H-NMR(400.2 MHz, d₆-DMSO):
δ = 9.1750 (1.7); 9.1554 (1.7); 8.1047 (7.8); 7.3679 (1.3); 7.3485 (2.8); 7.3292 (1.7); 7.2073 (3.4);
7.1831 (4.6); 7.1711 (5.0); 7.1135 (2.1); 7.0944 (1.8); 7.0707 (4.3); 7.0483 (1.8); 7.0260 (1.8); 7.0165
(1.0); 5.0919 (1.1); 5.0736 (1.6); 5.0555 (1.1); 3.9021 (0.8); 3.3264 (71.8); 2.6707 (0.8); 2.5407 (0.9);
2.5057 (109.0); 2.5018 (131.7); 2.3387 (15.5); 2.1847 (16.0); 1.4319 (7.6); 1.4145 (7.5); −0.0002 (0.4)
I-139: ¹H-NMR(400.1 MHz, CDCl3):
δ = 7.5648 (1.4); 7.5448 (6.8); 7.5291 (16.0); 7.4676 (10.8); 7.4630 (10.6); 7.4282 (8.3); 7.3650 (0.8);
7.3535 (3.0); 7.3468 (4.6); 7.3411 (3.9); 7.3312 (3.6); 7.2616 (8.9); 7.1971 (4.3); 7.1926 (4.1); 7.1767
(6.6); 7.1722 (6.4); 7.1076 (10.5); 7.0871 (6.6); 6.6454 (2.8); 6.6159 (3.1); 6.6012 (3.2); 6.5717 (3.3);
6.3179 (2.6); 6.0577 (0.4); 6.0301 (9.0); 5.9858 (7.6); 5.8198 (0.4); 5.7901 (0.6); 5.7769 (8.2); 5.7474
(7.5); 3.7356 (3.4); 3.7190 (9.3); 3.7028 (9.3); 3.6864 (3.4); 3.0067 (6.8); 2.9896 (13.1); 2.9725 (6.0);
2.0260 (0.8); 1.5927 (5.6); 1.2679 (0.6); 1.2560 (0.7); 1.2507 (0.7); 0.8811 (0.3); −0.0002
(8.0); −0.0082 (0.4)
I-140: ¹H-NMR(400.1 MHz, CDCl3):
δ = 7.5652 (0.5); 7.5452 (5.4); 7.5323 (7.1); 7.4424 (3.9); 7.4085 (0.6); 7.3988 (1.6); 7.3923 (1.7);
7.3879 (2.2); 7.3831 (2.0); 7.3764 (1.5); 7.3703 (1.1); 7.3481 (3.4); 7.3281 (3.7); 7.2583 (6.3); 7.0441
(4.3); 6.9548 (2.3); 6.9352 (2.1); 6.4342 (1.0); 6.4194 (1.8); 6.4047 (1.0); 4.2375 (1.7); 4.2220 (1.8);
4.2014 (3.6); 4.1859 (3.4); 4.1652 (1.8); 4.1498 (1.7); 2.4783 (12.0); 2.3178 (0.5); 2.2737 (16.0);
1.5702 (1.0); 1.2559 (0.4); −0.0002 (5.1)
I-141: ¹H-NMR(400.1 MHz, d₆-DMSO):
δ = 9.2171 (0.7); 9.2028 (1.5); 9.1881 (0.8); 8.2950 (1.1); 8.2753 (2.0); 8.2555 (1.2); 8.1371 (7.3);
8.1245 (0.4); 7.9531 (2.5); 7.8640 (2.8); 7.8454 (2.6); 7.7457 (3.4); 7.6998 (0.4); 7.6148 (2.6); 7.5941
(2.5); 7.5248 (1.0); 7.5206 (1.0); 7.5040 (2.2); 7.4996 (2.3); 7.4716 (3.8); 7.4507 (1.8); 5.9230 (0.5);
5.9108 (1.0); 5.8978 (0.5); 5.8073 (0.5); 5.7956 (0.8); 5.7821 (0.5); 3.7820 (0.7); 3.7698 (1.5); 3.7555
(0.9); 3.7273 (0.6); 3.7197 (0.7); 3.7119 (1.2); 3.6964 (0.7); 3.3014 (10.9); 2.8909 (16.0); 2.7319
(14.3); 2.5053 (8.2); 2.5010 (11.1); 2.4967 (8.3); −0.0002 (4.3)
I-142: ¹H-NMR(400.0 MHz, d₆-DMSO):
δ = 9.0909 (1.4); 9.0761 (3.0); 9.0616 (1.5); 8.0813 (13.8); 7.7637 (1.1); 7.7443 (9.8); 7.7250 (3.4);
7.7072 (4.3); 7.6869 (6.6); 7.6041 (2.9); 7.5839 (2.3); 7.4958 (0.6); 7.4755 (16.0); 7.4510 (0.5);
6.0461 (1.1); 6.0330 (1.9); 6.0210 (1.1); 5.9307 (1.0); 5.9178 (2.0); 5.9056 (1.1); 3.8979 (1.7); 3.8828
(2.6); 3.8729 (1.3); 3.8675 (1.2); 3.8398 (1.9); 3.8257 (2.9); 3.8127 (1.4); 3.3214 (30.9); 2.6710 (0.9);
2.6667 (0.7); 2.5062 (117.2); 2.5019 (150.2); 2.4976 (108.9); 2.3328 (0.7); 2.3285 (0.9); 2.3241
(0.6); −0.0001 (0.8)
I-143: ¹H-NMR(400.0 MHz, d₆-DMSO):
δ = 8.9469 (1.2); 8.9256 (1.2); 7.8026 (5.0); 7.7189 (0.5); 7.6986 (1.4); 7.6782 (1.2); 7.6374 (1.6);
7.6237 (2.5); 7.6210 (2.6); 7.5793 (1.1); 7.5577 (0.9); 7.2172 (1.6); 7.1969 (1.6); 6.6562 (4.3); 6.6357
(1.3); 6.6290 (0.8); 5.1301 (0.6); 5.1125 (0.7); 3.6895 (16.0); 3.3643 (42.4); 2.8910 (1.3); 2.7320
(1.6); 2.7187 (1.3); 2.7042 (1.3); 2.6901 (0.5); 2.6030 (13.1); 2.5128 (5.8); 2.5085 (12.3); 2.5040
(16.7); 2.4995 (12.2); 2.4950 (6.0); 1.9702 (0.4); 1.9585 (0.5); 1.9493 (0.6); 1.9352 (0.3); 1.8823
(0.3); 1.8689 (0.4); 1.8563 (0.4); 1.8364 (0.4); 1.7657 (0.5); 1.7467 (0.9); 1.7368 (1.0); 1.7228 (0.8)
I-144: ¹H-NMR(300.2 MHz, CDCl3):
δ = 7.6228 (0.6); 7.5964 (2.5); 7.5752 (7.5); 7.5534 (0.7); 7.5042 (3.4); 7.4751 (3.6); 7.4468 (9.3);
7.4404 (5.8); 7.4330 (1.9); 7.4184 (1.5); 7.4106 (0.9); 7.2988 (18.5); 7.2767 (3.0); 7.2698 (2.8);
7.2488 (2.2); 7.2420 (2.1); 6.4540 (0.9); 6.4336 (1.6); 6.4130 (0.9); 6.0965 (0.9); 6.0865 (1.0); 6.0723
(1.0); 6.0623 (0.9); 5.9407 (0.9); 5.9307 (1.0); 5.9166 (1.0); 5.9064 (0.9); 4.3068 (0.5); 4.2967 (0.5);
4.2843 (0.5); 4.2742 (0.5); 4.2579 (0.7); 4.2477 (0.7); 4.2355 (0.6); 4.2250 (0.6); 4.2145 (0.6); 4.2042
(0.5); 4.1919 (0.5); 4.1817 (0.5); 4.1654 (0.7); 4.1552 (0.6); 4.1429 (0.7); 4.1328 (0.6); 3.9394 (0.6);
3.9205 (0.7); 3.9150 (0.7); 3.8961 (0.7); 3.8903 (0.6); 3.8681 (1.1); 3.8483 (1.0); 3.8252 (0.7); 3.8197
(0.6); 3.8006 (0.6); 3.7953 (0.5); 3.7763 (0.5); 2.8578 (0.5); 2.8399 (0.8); 2.8326 (0.7); 2.8148 (2.6);
2.7952 (2.9); 2.7897 (2.8); 2.7704 (2.8); 2.7522 (0.8); 2.7457 (0.9); 2.7275 (0.5); 2.0431 (1.9); 1.6050
(16.0); 1.3515 (5.7); 1.3265 (13.0); 1.3014 (5.6); 0.0472 (0.6); 0.0363 (19.1); 0.0252 (0.7)
I-145: ¹H-NMR(300.2 MHz, CDCl3):
δ = 7.5710 (0.6); 7.5465 (1.6); 7.5214 (1.6); 7.4942 (0.8); 7.3644 (1.0); 7.3491 (2.9); 7.3419 (3.6);
7.3090 (0.7); 7.3060 (0.7); 7.2985 (10.2); 7.2509 (2.2); 7.2235 (2.9); 7.0738 (1.8); 7.0667 (1.7);
7.0465 (1.3); 7.0394 (1.3); 6.1659 (0.4); 6.1479 (0.8); 6.1293 (0.4); 3.8857 (1.1); 3.8639 (2.9); 3.8426
(3.0); 3.8207 (1.2); 3.1384 (2.1); 3.1160 (3.9); 3.0937 (1.8); 2.6362 (0.7); 2.6219 (16.0); 2.3467
(16.0); 2.2077 (0.4); 2.0793 (0.8); 1.7589 (0.4); 1.2951 (0.5); 0.0478 (0.4); 0.0371 (10.6); 0.0261 (0.4)
I-146: ¹H-NMR(300.2 MHz, CDCl3):
δ = 7.4303 (1.6); 7.4034 (3.8); 7.3771 (5.8); 7.3517 (3.9); 7.3219 (3.1); 7.2986 (25.6); 7.2252 (2.9);
7.2187 (4.5); 7.2125 (2.8); 7.1798 (0.4); 7.1511 (0.4); 7.1338 (2.3); 7.0885 (4.5); 7.0107 (2.3); 6.9847
(2.0); 6.7764 (0.9); 6.7568 (1.6); 6.7366 (0.9); 4.9659 (1.6); 4.9404 (3.8); 4.9288 (2.2); 4.9214 (2.2);
4.8928 (0.4); 4.8136 (1.8); 4.7860 (4.6); 4.7711 (5.6); 4.7296 (1.5); 4.7076 (0.6); 4.5952 (0.4); 4.2494
(1.5); 4.2290 (1.4); 4.2005 (3.0); 4.1801 (2.8); 4.1518 (1.6); 4.1316 (1.4); 3.7932 (1.1); 3.7698 (3.0);
3.7464 (3.1); 3.7230 (1.2); 3.5267 (8.0); 3.3959 (0.4); 3.3833 (0.5); 2.9902 (0.7); 2.9097 (0.6); 2.5071
(11.5); 2.3447 (16.0); 1.6380 (0.9); 1.5721 (0.6); 1.5105 (0.5); 1.4800 (0.7); 1.4507 (0.9); 1.3030
(7.6); 1.2940 (10.9); 1.2801 (8.7); 1.2567 (4.5); 1.1956 (0.6); 1.1444 (1.8); 1.0466 (0.3); 1.0274 (0.4);
1.0158 (0.4); 0.9816 (0.4); 0.9184 (1.7); 0.8936 (1.6); 0.8693 (1.1); 0.2431 (0.5); 0.2321 (0.4); 0.2218
(0.9); 0.2095 (1.1); 0.1811 (2.1); 0.1711 (2.2); 0.1078 (0.7); 0.0485 (1.1); 0.0378 (22.3); 0.0272 (1.3)
I-147: ¹H-NMR(499.9 MHz, CDCl3):
δ = 8.3199 (6.9); 7.8605 (1.2); 7.8454 (1.3); 7.6182 (0.4); 7.6007 (3.3); 7.5909 (6.6); 7.4925 (3.5);
7.4462 (0.3); 7.4376 (1.2); 7.4307 (1.8); 7.4269 (1.8); 7.4201 (1.5); 7.2592 (5.5); 6.5924 (6.6); 5.3524
(1.3); 5.3393 (1.5); 5.3266 (0.6); 2.6171 (0.3); 2.5832 (2.8); 2.5716 (2.8); 2.5383 (0.4); 2.2936 (0.4);
2.2843 (0.5); 2.2711 (1.2); 2.2632 (1.1); 2.2540 (0.8); 2.2435 (0.8); 2.2358 (0.4); 1.9206 (0.3); 1.9038
(1.5); 1.8897 (2.0); 1.8774 (3.2); 1.8732 (3.1); 1.8510 (1.3); 1.8296 (0.4); 1.5524 (1.8); 1.4224 (0.5);
1.3360 (0.7); 1.2840 (1.6); 1.2561 (16.0); 1.1608 (0.5); 1.1416 (0.4); 1.1304 (0.4); 1.1068 (0.7);
0.8928 (1.2); 0.8894 (1.2); 0.8804 (1.6); 0.8673 (1.2); 0.8412 (1.5); 0.7158 (0.4); −0.0002 (5.1)
I-148: ¹H-NMR(300.2 MHz, CDCl3):
δ = 8.1927 (2.9); 7.6091 (0.4); 7.5815 (1.4); 7.5554 (5.8); 7.5338 (16.0); 7.5169 (2.3); 7.4890 (9.7);
7.4601 (15.8); 7.4347 (3.6); 7.4142 (2.5); 7.3855 (7.6); 7.3632 (13.5); 7.3348 (11.4); 7.3267 (6.6);
7.3194 (3.7); 7.3122 (2.4); 7.2986 (47.4); 5.4637 (0.4); 4.2048 (4.0); 4.1845 (3.9); 4.1730 (0.8);
4.1578 (8.4); 4.1374 (8.1); 4.1107 (4.2); 4.0904 (4.1); 4.0504 (0.4); 4.0295 (0.4); 3.1671 (0.6); 3.1547
(1.4); 3.1443 (2.5); 3.1321 (3.4); 3.1219 (3.4); 3.1095 (2.6); 3.0991 (1.5); 3.0871 (0.7); 2.3765 (0.9);
2.3594 (2.2); 2.3490 (2.3); 2.3424 (1.6); 2.3322 (4.4); 2.3217 (1.6); 2.3150 (2.5); 2.3048 (2.3); 2.2878
(1.1); 1.6086 (12.7); 1.4613 (0.3); 1.3710 (0.4); 1.3217 (0.8); 1.2934 (4.2); 1.2557 (0.6); 1.2200 (2.6);
1.2050 (7.6); 1.1974 (8.6); 1.1883 (8.0); 1.1805 (8.3); 1.1679 (3.5); 1.1346 (0.6); 1.1182 (0.6); 1.0839
(0.7); 1.0633 (0.5); 1.0556 (0.6); 1.0338 (3.6); 1.0212 (7.9); 1.0131 (6.9); 1.0066 (4.6); 0.9941 (7.9);
0.9859 (7.1); 0.9713 (2.6); 0.9250 (2.3); 0.9191 (1.8); 0.9079 (5.8); 0.9016 (8.1); 0.8848 (8.4); 0.8787
(6.8); 0.8617 (3.3); 0.8320 (0.6); 0.8093 (0.6); 0.7966 (0.6); 0.7832 (0.5); 0.7432 (2.9); 0.7274 (7.0);
0.7195 (8.3); 0.7148 (7.0); 0.7077 (5.9); 0.6908 (2.1); 0.1073 (5.4); 0.0480 (1.1); 0.0372 (34.6);
0.0262 (1.3)
I-149: ¹H-NMR(300.2 MHz, CDCl3):
δ = 7.6475 (2.2); 7.6423 (1.7); 7.6302 (3.8); 7.5815 (2.0); 7.5531 (2.4); 7.5380 (1.9); 7.5342 (1.9);
7.5320 (2.0); 7.4885 (1.9); 7.4576 (0.4); 7.4440 (0.9); 7.4356 (0.9); 7.4294 (1.3); 7.4233 (1.0); 7.4136
(0.7); 7.4054 (0.6); 7.2986 (7.8); 7.2633 (1.3); 7.2567 (1.2); 7.2351 (1.0); 7.2284 (1.0); 6.6051 (0.5);
6.5840 (0.9); 6.5628 (0.5); 4.4884 (0.9); 4.4670 (0.9); 4.4518 (0.3); 4.4398 (2.0); 4.4184 (1.9); 4.3912
(1.0); 4.3698 (0.9); 2.5840 (16.0); 2.5607 (1.8); 1.6228 (4.4); 1.2914 (1.3); 0.9176 (0.6); 0.0357 (5.3)
I-150: ¹H-NMR(400.0 MHz, d₆-DMSO):
δ = 9.1912 (1.3); 9.1714 (1.4); 7.8021 (6.2); 7.7319 (0.6); 7.7121 (1.8); 7.6925 (1.5); 7.6689 (2.3);
7.6547 (2.0); 7.6353 (1.0); 7.6096 (2.8); 7.5915 (1.4); 7.5718 (1.0); 7.4228 (1.4); 7.4177 (1.9); 7.4142
(1.6); 7.4034 (1.9); 7.3982 (2.8); 7.3943 (2.0); 7.2754 (2.1); 7.2559 (3.1); 7.2364 (1.3); 5.1556 (0.8);
5.1372 (1.2); 5.1191 (0.8); 3.3526 (18.2); 2.8912 (1.2); 2.7332 (1.0); 2.6096 (16.0); 2.5139 (4.5);
2.5095 (9.6); 2.5050 (13.0); 2.5004 (9.4); 2.4960 (4.6); 1.4425 (6.2); 1.4250 (6.1)
I-151: ¹H-NMR(300.2 MHz, CDCl3):
δ = 8.1772 (4.8); 8.0487 (0.4); 8.0302 (0.6); 7.6460 (1.4); 7.6393 (1.2); 7.6347 (1.2); 7.6278 (3.4);
7.6245 (3.2); 7.5124 (1.6); 7.4773 (0.7); 7.4656 (0.9); 7.4590 (0.8); 7.4469 (0.7); 7.4389 (0.4); 7.3754
(1.6); 7.3488 (1.8); 7.2987 (7.5); 7.0704 (1.7); 6.9811 (1.0); 6.9546 (0.8); 4.3137 (0.9); 4.2939 (0.9);
4.2655 (1.9); 4.2457 (1.8); 4.2174 (1.0); 4.1975 (1.0); 4.1703 (0.4); 4.1466 (0.4); 3.1040 (1.0); 3.0787
(3.3); 3.0534 (3.4); 3.0280 (1.2); 2.5225 (3.0); 2.5158 (5.3); 2.5085 (3.0); 2.3133 (7.2); 2.0832 (1.6);
1.6161 (16.0); 1.4315 (3.8); 1.4062 (8.0); 1.3809 (3.7); 1.3203 (0.8); 1.2965 (2.4); 1.2727 (0.6);
0.9402 (0.5); 0.9184 (1.6); 0.8953 (0.6); 0.1071 (1.8); 0.0364 (6.4)
I-152: ¹H-NMR(400.2 MHz, d₆-DMSO):
δ = 9.0046 (0.4); 8.9895 (1.0); 8.9741 (1.0); 8.9591 (0.4); 7.7689 (4.8); 7.7285 (0.6); 7.7088 (1.6);
7.6887 (1.4); 7.6626 (1.9); 7.6392 (1.6); 7.6335 (1.5); 7.6172 (1.0); 7.5532 (1.8); 7.5498 (2.1); 7.5467
(2.0); 7.5356 (2.0); 7.5150 (1.7); 7.4745 (1.2); 7.4540 (2.1); 7.4242 (1.0); 7.4199 (0.9); 7.4039 (0.7);
7.3995 (0.6); 7.3020 (0.7); 7.2985 (0.7); 7.2820 (0.7); 6.3576 (1.0); 6.3487 (2.4); 6.0462 (0.4); 6.0150
(0.4); 5.9308 (0.5); 5.9189 (0.3); 5.8988 (0.5); 5.4665 (1.6); 5.1691 (1.4); 4.0377 (1.0); 4.0199 (1.0);
3.8871 (0.3); 3.8748 (0.5); 3.8661 (0.9); 3.8530 (0.9); 3.8389 (0.4); 3.8276 (0.6); 3.8114 (1.1); 3.7965
(1.0); 3.7826 (0.4); 3.3247 (38.8); 2.6755 (0.6); 2.6709 (0.9); 2.6664 (0.7); 2.5975 (16.0); 2.5244
(2.9); 2.5198 (4.4); 2.5110 (51.9); 2.5065 (105.2); 2.5019 (139.8); 2.4973 (102.5); 2.4929 (50.2);
2.3333 (0.6); 2.3288 (0.9); 2.3243 (0.6); 2.0491 (5.2); 1.9889 (4.2); 1.8421 (2.0); 1.8307 (2.1); 1.3976
(3.4); 1.1927 (1.2); 1.1749 (2.3); 1.1571 (1.1); −0.0002 (4.5)
I-153: ¹H-NMR(300.2 MHz, CDCl3):
δ = 7.4031 (1.5); 7.3765 (1.7); 7.2986 (10.2); 7.1174 (0.3); 7.0906 (3.3); 7.0764 (3.4); 7.0730 (3.7);
7.0636 (1.6); 7.0453 (0.4); 7.0111 (1.0); 6.9843 (0.8); 6.8402 (0.6); 6.8233 (0.8); 6.8183 (0.7); 6.8087
(1.0); 6.7948 (0.5); 6.7861 (0.4); 6.5500 (0.4); 6.5303 (0.7); 6.5108 (0.4); 4.3415 (0.5); 4.3017 (0.8);
4.2806 (0.8); 4.2527 (1.8); 4.2316 (1.7); 4.2035 (0.9); 4.1825 (0.9); 4.0773 (16.0); 2.5239 (5.3);
2.5172 (3.0); 2.3785 (0.4); 2.3335 (6.9); 2.1266 (0.4); 2.1158 (0.5); 2.0985 (0.8); 2.0816 (0.6); 2.0702
(0.5); 1.5897 (6.2); 1.2967 (0.5); 1.0682 (0.6); 1.0528 (1.6); 1.0460 (1.7); 1.0314 (0.9); 1.0242 (1.7);
1.0177 (1.6); 1.0031 (0.8); 0.9207 (0.5); 0.8077 (0.8); 0.7927 (1.8); 0.7868 (1.8); 0.7757 (1.7); 0.7700
(2.0); 0.7537 (0.6); 0.1084 (0.3); 0.0494 (0.4); 0.0386 (12.6); 0.0277 (0.5)
I-154: ¹H-NMR(400.1 MHz, CDCl3):
δ = 7.6881 (0.4); 7.6355 (8.6); 7.5790 (1.6); 7.5595 (5.8); 7.5424 (16.0); 7.5284 (1.9); 7.5190 (1.7);
7.4557 (12.8); 7.4348 (10.6); 7.4177 (0.6); 7.4059 (0.7); 7.3911 (3.2); 7.3852 (5.4); 7.3798 (3.5);
7.3759 (2.5); 7.3677 (4.1); 7.3610 (7.4); 7.3565 (6.0); 7.3396 (3.9); 7.3353 (3.8); 7.2595 (57.9);
6.7008 (4.9); 6.6714 (5.5); 6.6565 (5.8); 6.6271 (5.9); 6.2856 (2.0); 6.2698 (3.6); 6.2547 (2.0); 6.0524
(10.4); 6.0081 (9.1); 5.8384 (0.4); 5.8223 (10.4); 5.8091 (0.5); 5.7929 (9.6); 4.3791 (3.5); 4.3631
(3.5); 4.3425 (7.4); 4.3265 (7.0); 4.3059 (3.7); 4.2900 (3.5); 3.3694 (0.8); 1.5387 (33.2); 1.3031 (0.5);
1.2648 (2.3); 0.8986 (1.1); 0.8820 (2.9); 0.8643 (1.3); 0.0078 (3.2); −0.0002 (59.6); −0.0084 (2.7)
I-155: ¹H-NMR(400.1 MHz, CDCl3):
δ = 7.5401 (4.7); 7.5272 (5.2); 7.4270 (3.0); 7.4017 (0.4); 7.3923 (1.3); 7.3861 (1.3); 7.3800 (1.8);
7.3754 (1.5); 7.3698 (1.2); 7.3635 (0.9); 7.3433 (3.8); 7.3191 (2.6); 7.3043 (1.6); 7.2859 (2.6); 7.2670
(1.5); 7.2591 (5.5); 7.2466 (2.3); 7.2281 (1.1); 6.4631 (0.8); 6.4484 (1.4); 6.4335 (0.8); 4.2025 (1.4);
4.1870 (1.4); 4.1667 (3.0); 4.1512 (2.8); 4.1309 (1.5); 4.1154 (1.4); 2.3745 (0.4); 2.3467 (16.0);
1.5702 (1.6); 1.2988 (0.4); 1.2866 (0.4); 1.2822 (0.4); 1.2699 (0.4); 1.2563 (0.7); 0.0714
(0.6); −0.0002 (4.2)
I-156: ¹H-NMR(400.1 MHz, CDCl3):
δ = 8.2499 (16.0); 8.0864 (0.7); 8.0161 (1.6); 7.8729 (0.5); 7.6047 (2.0); 7.5854 (4.7); 7.5650 (3.4);
7.5452 (4.4); 7.5255 (1.7); 7.3756 (2.0); 7.3207 (0.4); 7.2596 (29.7); 7.1954 (3.2); 7.1766 (4.0);
7.0988 (2.8); 7.0790 (2.7); 7.0534 (2.6); 7.0381 (7.4); 7.0187 (2.0); 7.0162 (2.0); 6.9339 (3.2); 6.9312
(3.3); 6.9140 (5.4); 6.9113 (4.9); 6.8577 (2.5); 6.8549 (2.4); 6.8370 (3.4); 6.8195 (1.3); 6.8168 (1.3);
3.5217 (0.8); 3.5115 (1.7); 3.5018 (2.0); 3.4925 (2.6); 3.4835 (2.1); 3.4739 (1.8); 3.4636 (0.9); 2.9535
(12.5); 2.8813 (11.4); 2.5162 (1.1); 2.4961 (2.8); 2.4763 (2.9); 2.4563 (1.2); 1.6254 (1.6); 1.6085
(3.0); 1.6034 (2.0); 1.5916 (2.2); 1.5865 (3.0); 1.5694 (2.4); 1.5532 (6.5); 1.4098 (1.4); 1.3941 (1.3);
1.2109 (1.6); 1.2004 (1.8); 1.1940 (2.8); 1.1837 (2.8); 1.1773 (1.7); 1.1668 (1.5); 0.0078 (0.5); −0.0002
(13.1); −0.0082 (0.6)
I-157: ¹H-NMR(300.2 MHz, CDCl3):
δ = 9.5213 (1.4); 8.7150 (6.7); 8.7097 (4.4); 8.7001 (4.4); 8.6949 (6.8); 8.0787 (0.9); 8.0598 (1.7);
8.0416 (0.9); 7.6316 (0.6); 7.6055 (3.5); 7.5996 (3.0); 7.5946 (3.1); 7.5877 (7.7); 7.5843 (7.7); 7.5742
(1.2); 7.5689 (1.3); 7.5482 (8.0); 7.5429 (5.0); 7.5334 (5.0); 7.5280 (7.7); 7.4641 (3.8); 7.4487 (0.9);
7.4417 (0.7); 7.4335 (1.7); 7.4218 (2.4); 7.4152 (2.1); 7.4035 (1.7); 7.3952 (1.0); 7.3589 (3.6); 7.3323
(4.1); 7.2986 (8.4); 7.0576 (4.0); 6.9542 (2.2); 6.9278 (1.9); 4.2552 (1.8); 4.2358 (1.8); 4.2074 (3.9);
4.1879 (3.7); 4.1594 (2.0); 4.1399 (1.9); 2.5037 (11.8); 2.4965 (6.9); 2.3628 (0.5); 2.3085 (16.0);
2.2280 (0.4); 2.2151 (0.8); 2.2062 (1.2); 2.1929 (1.6); 2.1844 (1.5); 2.1714 (1.2); 2.1627 (0.8); 2.1497
(0.3); 1.7133 (2.4); 1.2936 (1.2); 0.4755 (0.6); 0.4615 (1.0); 0.4486 (3.1); 0.4356 (5.0); 0.4223 (2.9);
0.4130 (2.6); 0.4055 (2.9); 0.3985 (3.2); 0.3913 (3.1); 0.3754 (2.9); 0.3499 (0.7); 0.1089 (2.8); 0.0474
(0.4); 0.0366 (8.3); 0.0256 (0.4)
I-158: ¹H-NMR(300.2 MHz, d₆-DMSO):
δ = 9.1372 (0.4); 8.7318 (0.6); 8.7248 (0.6); 8.0804 (2.3); 7.9699 (0.4); 7.9619 (0.4); 7.9418 (0.5);
7.9337 (0.5); 7.7379 (0.8); 7.7097 (0.7); 7.6485 (0.5); 7.6224 (0.4); 7.5460 (0.4); 7.4446 (0.6); 7.4166
(0.3); 7.4131 (0.4); 7.2993 (0.3); 7.1137 (0.8); 6.9282 (0.4); 4.2577 (0.5); 4.2367 (0.4); 3.3457 (16.0);
2.5343 (0.6); 2.5283 (1.2); 2.5223 (1.7); 2.5162 (1.2); 2.5104 (0.6); 1.2558 (0.3); 0.0199 (0.8)
I-159: ¹H-NMR(400.0 MHz, d₆-DMSO):
δ = 9.2111 (1.6); 9.1909 (1.6); 7.9531 (1.3); 7.8137 (5.7); 7.7966 (2.9); 7.7525 (2.0); 7.7313 (2.9);
7.7137 (1.9); 7.6927 (2.4); 7.6862 (2.6); 7.6658 (2.1); 7.6466 (1.0); 7.5992 (3.5); 7.5771 (3.3); 7.5206
(1.6); 7.5170 (1.7); 7.4993 (1.3); 7.4956 (1.4); 7.2727 (2.4); 7.2669 (2.6); 7.1020 (1.6); 7.0958 (1.5);
7.0797 (1.4); 7.0734 (1.4); 5.2930 (0.8); 5.2749 (1.2); 5.2563 (0.8); 3.8489 (16.0); 3.3585 (45.7);
3.3538 (51.4); 2.8900 (7.6); 2.7320 (7.0); 2.6114 (14.5); 2.5083 (17.8); 2.5040 (23.9); 2.4997 (18.1);
1.5299 (5.6); 1.5125 (5.6); −0.0002 (0.4)
I-160: ¹H-NMR(300.2 MHz, CDCl3):
δ = 8.1859 (5.9); 8.0649 (0.5); 8.0475 (0.8); 8.0302 (0.5); 7.6589 (1.6); 7.6386 (4.5); 7.6231 (0.4);
7.6189 (0.4); 7.5396 (2.1); 7.4815 (0.9); 7.4712 (1.4); 7.4640 (3.1); 7.4507 (1.0); 7.4358 (4.6); 7.4258
(1.9); 7.2985 (7.9); 7.2658 (1.7); 7.2590 (1.6); 7.2379 (1.3); 7.2313 (1.2); 6.1459 (0.5); 6.1354 (0.6);
6.1222 (0.6); 6.1117 (0.6); 5.9904 (0.5); 5.9800 (0.6); 5.9668 (0.6); 5.9562 (0.6); 4.3162 (0.4); 4.3054
(0.4); 4.2937 (0.4); 4.2829 (0.4); 4.2741 (0.3); 4.2516 (0.3); 4.2253 (0.4); 4.2146 (0.4); 4.2030 (0.4);
4.1922 (0.4); 3.9022 (0.4); 3.8850 (0.4); 3.8784 (0.4); 3.8612 (0.4); 3.8535 (0.3); 3.8313 (0.6); 3.8140
(0.6); 3.7908 (0.4); 3.7830 (0.4); 3.7659 (0.3); 3.1093 (1.3); 3.0840 (4.0); 3.0587 (4.2); 3.0334 (1.4);
1.6160 (16.0); 1.4348 (4.6); 1.4095 (9.6); 1.3841 (4.4); 1.2955 (1.4); 0.9393 (0.4); 0.9174 (1.2);
0.8943 (0.5); 0.1061 (1.9); 0.0354 (7.0)
I-161: ¹H-NMR(300.2 MHz, CDCl3):
δ = 7.9499 (5.7); 7.9412 (5.7); 7.6323 (0.5); 7.6058 (3.2); 7.5990 (2.8); 7.5939 (3.1); 7.5876 (8.0);
7.5842 (7.9); 7.4838 (3.7); 7.4673 (0.7); 7.4518 (1.6); 7.4407 (2.2); 7.4341 (2.0); 7.4218 (1.6); 7.4139
(1.0); 7.3310 (3.6); 7.2986 (19.2); 7.0354 (4.0); 6.9266 (2.2); 6.8997 (1.9); 6.6942 (1.0); 6.6743 (2.0);
6.6542 (1.1); 6.5973 (5.9); 6.5885 (5.8); 5.0749 (1.5); 5.0680 (0.8); 5.0520 (2.7); 5.0311 (2.2); 4.1324
(1.4); 4.1112 (1.4); 4.0851 (3.0); 4.0708 (2.5); 4.0654 (4.2); 4.0436 (2.8); 4.0354 (2.1); 4.0282 (1.2);
4.0165 (1.7); 3.9865 (1.8); 3.9629 (2.5); 3.9416 (1.8); 3.9350 (1.4); 3.9143 (0.8); 2.4646 (12.0);
2.4577 (6.9); 2.4066 (0.5); 2.3834 (1.0); 2.3680 (1.0); 2.3615 (1.4); 2.3499 (1.2); 2.3418 (1.7); 2.3258
(1.0); 2.3170 (1.1); 2.3041 (0.7); 2.2708 (16.0); 2.1806 (0.5); 2.1568 (1.2); 2.1317 (1.7); 2.1244 (0.7);
2.1098 (2.1); 2.1047 (2.2); 2.0976 (2.2); 2.0869 (3.7); 2.0830 (3.5); 2.0692 (2.9); 2.0625 (2.3); 2.0465
(2.1); 2.0425 (1.6); 2.0384 (1.3); 2.0229 (0.6); 2.0125 (0.5); 1.6402 (1.9); 0.1085 (1.1); 0.0491 (0.9);
0.0383 (21.2); 0.0274 (0.9)
I-162: ¹H-NMR(499.9 MHz, CDCl3):
δ = 7.5253 (0.4); 7.5075 (3.4); 7.4978 (4.6); 7.4256 (2.6); 7.3564 (1.0); 7.3480 (1.4); 7.3450 (1.3);
7.3392 (1.1); 7.3210 (2.2); 7.3050 (2.4); 7.2587 (3.3); 7.0324 (3.1); 6.9957 (0.7); 6.9845 (1.2); 6.9728
(0.7); 6.9553 (1.7); 6.9393 (1.5); 4.1950 (1.0); 4.1825 (1.0); 4.1652 (2.1); 4.1528 (2.0); 4.1354 (1.1);
4.1229 (1.1); 4.1137 (1.0); 4.0181 (16.0); 2.4590 (8.2); 2.3379 (0.7); 2.2896 (11.1); 2.1585 (0.6);
1.5743 (4.8); 1.2660 (0.8); 0.8955 (0.5); 0.8820 (1.0); 0.8679 (0.5); −0.0002 (3.0)
I-163: ¹H-NMR(400.1 MHz, CDCl3):
δ = 7.9799 (1.5); 7.5488 (1.4); 7.5289 (6.5); 7.5140 (16.0); 7.5119 (14.5); 7.4470 (0.8); 7.4317 (2.3);
7.4159 (10.4); 7.3983 (4.5); 7.3761 (6.9); 7.3702 (4.4); 7.3600 (4.1); 7.3459 (7.0); 7.3261 (3.9);
7.2600 (56.7); 7.2464 (4.3); 7.1646 (2.3); 7.1442 (3.9); 7.1236 (1.8); 6.5222 (2.0); 6.5073 (3.6);
6.4919 (2.0); 4.6497 (0.3); 4.5149 (0.7); 4.4975 (0.7); 4.3857 (5.2); 4.3682 (15.9); 4.3507 (16.0);
4.3333 (5.1); 4.2019 (3.9); 4.1861 (3.9); 4.1652 (8.2); 4.1494 (7.8); 4.1284 (4.4); 4.1126 (3.9); 4.0892
(0.4); 2.9470 (10.5); 2.8625 (9.4); 1.5494 (70.5); 1.5197 (0.9); 1.5022 (0.6); 1.4779 (0.6); 1.4551
(16.4); 1.4377 (32.5); 1.4202 (15.8); 1.3975 (1.4); 1.3801 (0.8); 1.3637 (0.3); 1.2221 (0.6); −0.0002 (16.3)
I-164: ¹H-NMR(300.2 MHz, CDCl3):
δ = 8.8915 (5.8); 7.8564 (0.4); 7.8389 (0.7); 7.8194 (0.4); 7.7230 (1.6); 7.7177 (1.4); 7.7127 (1.4);
7.7053 (3.5); 7.7019 (3.5); 7.6781 (1.8); 7.6749 (1.8); 7.5708 (1.6); 7.5210 (1.4); 7.5122 (0.9); 7.4995
(1.3); 7.4930 (4.0); 7.4819 (0.9); 7.4733 (0.6); 7.4625 (1.8); 7.4567 (1.6); 7.4343 (0.7); 7.4285 (0.7);
7.2984 (10.6); 4.5105 (0.9); 4.4901 (0.9); 4.4618 (1.9); 4.4414 (1.8); 4.4131 (1.0); 4.3927 (0.9);
2.8416 (16.0); 1.5919 (2.5); 0.1065 (0.5); 0.0471 (0.4); 0.0363 (10.2); 0.0253 (0.4)
I-165: ¹H-NMR(300.2 MHz, CDCl3):
δ = 8.2909 (16.0); 7.8875 (4.3); 7.6128 (3.6); 7.5910 (5.8); 7.5693 (3.8); 7.4651 (8.1); 7.4365 (17.3);
7.3672 (3.6); 7.3443 (6.5); 7.3215 (4.8); 7.3000 (5.6); 7.2804 (7.2); 7.2748 (6.8); 7.2526 (5.6); 7.2468
(5.4); 7.2279 (4.9); 7.2007 (6.4); 7.1974 (6.3); 7.1736 (2.9); 7.1046 (0.4); 7.0795 (0.5); 7.0582 (0.4);
6.1365 (2.4); 6.1265 (2.7); 6.1142 (2.7); 6.1044 (2.4); 5.9817 (2.4); 5.9713 (2.7); 5.9595 (2.7); 5.9494
(2.3); 5.3341 (3.6); 4.3300 (1.2); 4.3200 (1.3); 4.3088 (1.4); 4.2979 (1.4); 4.2818 (1.7); 4.2710 (1.8);
4.2599 (1.8); 4.2483 (2.0); 4.2331 (1.5); 4.2219 (1.5); 4.2112 (1.4); 4.1948 (1.7); 4.1843 (1.8); 4.1731
(1.7); 4.1628 (1.6); 4.1426 (0.4); 4.1303 (0.4); 3.9437 (1.4); 3.9245 (2.0); 3.9031 (1.7); 3.8954 (1.6);
3.8715 (2.7); 3.8531 (2.8); 3.8295 (1.8); 3.8220 (1.6); 3.8012 (1.6); 3.7813 (1.1); 2.0786 (0.6); 1.6680
(0.9); 1.2907 (1.8); 1.0524 (0.4); 1.0342 (0.7); 1.0125 (0.6); 0.7945 (0.3); 0.0347 (3.3)
I-166: ¹H-NMR(400.0 MHz, d₆-DMSO):
δ = 9.1659 (1.4); 9.1462 (1.4); 7.8144 (6.0); 7.7284 (0.6); 7.7084 (1.7); 7.6893 (1.5); 7.6503 (2.0);
7.6299 (3.6); 7.5747 (1.4); 7.5535 (1.1); 7.4708 (0.6); 7.4658 (0.7); 7.4513 (0.7); 7.4461 (0.8); 7.4412
(0.8); 7.4359 (0.8); 7.4213 (0.7); 7.4163 (0.7); 7.3764 (0.6); 7.3552 (1.4); 7.3498 (0.8); 7.3342 (1.0);
7.3285 (1.4); 7.3076 (0.9); 7.2571 (0.8); 7.2466 (0.9); 7.2308 (0.6); 7.2255 (0.6); 5.1495 (0.8); 5.1314
(1.3); 5.1134 (0.8); 3.3666 (48.2); 2.8933 (0.9); 2.7345 (0.8); 2.6131 (16.0); 2.5161 (5.8); 2.5117
(12.5); 2.5072 (17.0); 2.5027 (12.4); 2.4983 (6.1); 1.4366 (6.4); 1.4191 (6.4)
I-167: ¹H-NMR(400.2 MHz, d₆-DMSO):
δ = 9.0837 (1.5); 9.0626 (1.5); 7.8219 (6.7); 7.7226 (0.6); 7.7029 (1.7); 7.6821 (1.5); 7.6425 (4.5);
7.6261 (1.1); 7.5989 (1.6); 7.5799 (1.0); 7.1683 (2.8); 7.0495 (1.0); 7.0300 (1.9); 6.9829 (2.8); 6.9633
(1.6); 5.1764 (0.4); 5.1627 (0.8); 5.1425 (0.8); 5.1288 (0.4); 4.7336 (0.4); 4.6959 (2.8); 4.6856 (2.7);
4.6483 (0.4); 4.0183 (1.1); 4.0066 (1.2); 3.9900 (1.4); 3.9783 (1.3); 3.7575 (1.3); 3.7420 (1.3); 3.7291
(1.1); 3.7138 (1.1); 3.3311 (27.6); 2.6030 (16.0); 2.5246 (0.6); 2.5112 (9.8); 2.5070 (19.0); 2.5025
(24.5); 2.4980 (17.6); 2.4937 (8.6); 2.0599 (11.1); 1.2404 (0.8)
I-168: ¹H-NMR(499.9 MHz, CDCl3):
δ = 7.5200 (3.4); 7.5099 (3.7); 7.4944 (0.3); 7.4546 (2.9); 7.4375 (4.0); 7.4062 (2.2); 7.3579 (3.7);
7.3410 (2.8); 7.3209 (0.8); 7.3159 (0.9); 7.3108 (1.2); 7.3073 (1.1); 7.3029 (0.8); 7.2979 (0.7); 7.2602
(3.6); 7.1297 (0.5); 7.1182 (1.0); 7.1066 (0.6); 4.1419 (0.8); 4.1293 (0.9); 4.1126 (1.9); 4.1082 (1.4);
4.1001 (1.9); 4.0833 (1.1); 4.0708 (0.9); 4.0057 (16.0); 3.9933 (0.7); 1.5781 (3.2); 1.2553
(0.6); −0.0002 (3.2)
I-169: ¹H-NMR(400.1 MHz, CDCl3):
δ = 7.5247 (0.4); 7.5053 (4.6); 7.4925 (5.4); 7.4160 (3.1); 7.4021 (0.5); 7.3922 (1.4); 7.3861 (1.2);
7.3801 (1.8); 7.3754 (1.5); 7.3698 (1.0); 7.3635 (0.7); 7.2588 (5.8); 7.2330 (4.0); 7.2129 (5.7); 7.1263
(5.1); 7.1064 (3.5); 6.6583 (1.8); 6.6289 (2.0); 6.6140 (2.1); 6.5846 (2.1); 6.3749 (1.4); 6.3548 (1.3);
6.0263 (4.0); 5.9820 (3.5); 5.7381 (3.9); 5.7086 (3.6); 5.3097 (0.4); 5.2921 (1.2); 5.2737 (1.6); 5.2553
(1.1); 2.3201 (16.0); 2.2805 (0.5); 2.2736 (0.5); 1.5718 (8.8); 1.5591 (9.4); 1.5418 (9.2); 1.2648 (0.8);
0.8982 (0.4); 0.8817 (1.0); 0.8640 (0.4); −0.0002 (3.6)
I-170: ¹H-NMR(400.0 MHz, d₆-DMSO):
δ = 8.8246 (0.8); 8.8102 (1.6); 8.7960 (0.8); 8.0999 (9.2); 7.7559 (0.7); 7.7366 (2.1); 7.7169 (2.2);
7.7042 (2.5); 7.6841 (0.9); 7.6498 (2.8); 7.5863 (1.6); 7.5668 (1.3); 7.5472 (3.3); 7.4247 (1.0); 7.4049
(2.4); 7.4011 (2.4); 7.3767 (4.0); 7.3569 (1.7); 3.5764 (1.0); 3.5594 (2.6); 3.5441 (2.6); 3.5268 (1.1);
3.3228 (107.8); 2.9392 (1.9); 2.9218 (3.8); 2.9040 (1.8); 2.6752 (0.6); 2.6706 (0.8); 2.6661 (0.6);
2.5408 (66.4); 2.5238 (2.0); 2.5189 (2.9); 2.5102 (55.7); 2.5059 (117.5); 2.5015 (157.9); 2.4970
(112.4); 2.4926 (53.1); 2.3524 (0.4); 2.3367 (16.0); 1.2346 (0.4); 0.0079 (0.4); −0.0003
(14.6); −0.0083 (0.5)
I-171: ¹H-NMR(300.2 MHz, CDCl3):
δ = 9.3983 (0.6); 8.3454 (4.9); 7.6200 (1.8); 7.6159 (1.6); 7.6105 (1.4); 7.6024 (3.6); 7.5993 (3.8);
7.4677 (1.9); 7.4542 (0.4); 7.4394 (0.8); 7.4273 (1.1); 7.4205 (0.9); 7.4096 (0.8); 7.4016 (0.5); 7.3541
(1.8); 7.3275 (2.1); 7.2983 (6.8); 7.0687 (2.1); 6.9356 (1.1); 6.9092 (1.0); 4.7075 (1.1); 4.6904 (1.0);
4.6593 (2.2); 4.6421 (2.2); 4.6110 (1.1); 4.5939 (1.1); 2.7610 (16.0); 2.5037 (6.3); 2.4965 (3.5);
2.3094 (8.4); 2.0818 (1.0); 1.5964 (1.7); 1.3207 (0.3); 1.2968 (1.0); 0.1094 (0.3); 0.0388 (7.2)
I-172: ¹H-NMR(300.2 MHz, CDCl3):
δ = 8.1274 (3.2); 8.0424 (0.5); 7.6674 (1.3); 7.6494 (0.4); 7.6226 (1.0); 7.5962 (0.8); 7.5275 (0.9);
7.4972 (1.2); 7.4687 (2.1); 7.4359 (1.2); 7.4308 (1.1); 7.4096 (1.4); 7.3712 (0.7); 7.3437 (0.6); 7.3047
(9.1); 6.9326 (0.7); 6.7450 (1.4); 6.5574 (0.7); 5.3438 (0.7); 4.4997 (0.6); 4.4793 (0.6); 4.4520 (1.3);
4.4314 (1.3); 4.4042 (0.7); 4.3838 (0.6); 2.7607 (9.7); 2.0892 (0.6); 2.0515 (0.8); 1.6051 (16.0);
1.3031 (0.6); 0.0535 (0.3); 0.0428 (8.1)
I-173: ¹H-NMR(400.1 MHz, CDCl3):
δ = 8.6831 (5.1); 8.6788 (4.9); 8.4906 (4.8); 8.4848 (4.7); 8.2775 (11.7); 8.0155 (1.2); 7.8072 (3.5);
7.8017 (5.0); 7.7965 (3.2); 7.7431 (1.4); 7.3354 (3.5); 7.3154 (3.9); 7.2601 (45.4); 7.0519 (4.1);
6.9961 (0.4); 6.9806 (2.2); 6.9615 (2.0); 4.2545 (1.9); 4.2397 (1.8); 4.2183 (3.9); 4.2035 (3.7); 4.1821
(2.0); 4.1673 (1.8); 2.9551 (8.7); 2.8821 (7.7); 2.4727 (11.7); 2.3057 (16.0); 1.5505 (26.7); −0.0002 (2.4)
I-174: ¹H-NMR(400.1 MHz, CDCl3):
δ = 7.9765 (2.3); 7.5521 (1.4); 7.5325 (6.6); 7.5175 (15.4); 7.5155 (14.0); 7.4972 (9.7); 7.4757 (13.7);
7.4501 (1.0); 7.4177 (7.6); 7.3926 (13.4); 7.3712 (9.5); 7.3631 (3.8); 7.3552 (4.7); 7.3497 (3.6);
7.3393 (3.4); 7.3340 (2.1); 7.2601 (50.0); 6.5519 (2.0); 6.5370 (3.4); 6.5220 (1.9); 4.6377 (0.3);
4.6200 (0.4); 4.4915 (0.6); 4.4740 (0.7); 4.3562 (4.6); 4.3388 (14.5); 4.3213 (14.6); 4.3039 (4.6);
4.1942 (3.4); 4.1783 (3.4); 4.1577 (7.2); 4.1419 (6.9); 4.1212 (3.7); 4.1054 (3.4); 2.9467 (16.0);
2.8611 (14.4); 1.5522 (58.4); 1.5245 (0.6); 1.5067 (0.9); 1.4891 (0.5); 1.4768 (0.3); 1.4445 (14.8);
1.4271 (29.4); 1.4096 (14.2); 1.3851 (1.3); 1.3675 (0.7); −0.0002 (14.7)
I-175: ¹H-NMR(300.2 MHz, CDCl3):
δ = 8.2980 (0.6); 8.2885 (16.0); 8.0328 (1.0); 8.0128 (1.5); 7.4742 (4.5); 7.4462 (6.0); 7.4387 (3.9);
7.4338 (4.8); 7.4280 (3.8); 7.2985 (26.9); 7.2550 (3.6); 7.2481 (3.4); 7.2270 (2.9); 7.2202 (2.7);
7.2052 (1.0); 7.1776 (6.2); 7.1601 (6.9); 7.1550 (6.2); 7.1470 (3.6); 7.1280 (0.9); 7.1198 (0.4); 6.9473
(0.4); 6.9337 (1.6); 6.9181 (2.4); 6.9116 (1.8); 6.9027 (2.6); 6.8880 (1.4); 6.8798 (1.2); 6.1490 (1.1);
6.1381 (1.2); 6.1269 (1.2); 6.1161 (1.1); 5.9946 (1.1); 5.9837 (1.2); 5.9725 (1.2); 5.9618 (1.1); 4.3347
(0.6); 4.3237 (0.7); 4.3130 (0.6); 4.3019 (0.7); 4.2860 (0.8); 4.2750 (0.9); 4.2642 (0.8); 4.2529 (1.1);
4.2395 (0.6); 4.2287 (0.7); 4.2177 (0.7); 4.2017 (0.9); 4.1906 (0.8); 4.1799 (0.9); 4.1690 (0.8); 3.9672
(0.8); 3.9493 (1.0); 3.9456 (1.0); 3.9275 (0.9); 3.9186 (0.7); 3.9005 (0.8); 3.8966 (0.9); 3.8911 (1.0);
3.8787 (0.8); 3.8732 (1.1); 3.8695 (1.0); 3.8515 (0.8); 3.8424 (0.8); 3.8244 (0.8); 3.8206 (0.8); 3.8026
(0.6); 2.1946 (0.5); 2.1774 (1.1); 2.1663 (1.2); 2.1491 (2.2); 2.1317 (1.3); 2.1208 (1.2); 2.1032 (0.6);
1.5830 (15.7); 1.4704 (0.4); 1.1190 (1.6); 1.1037 (4.3); 1.0969 (4.6); 1.0910 (2.3); 1.0820 (2.4);
1.0751 (4.5); 1.0686 (4.1); 1.0538 (2.1); 0.8550 (2.2); 0.8399 (5.1); 0.8339 (4.7); 0.8229 (4.4); 0.8175
(5.4); 0.8009 (1.6); 0.1080 (0.6); 0.0489 (1.2); 0.0382 (33.6); 0.0272 (1.1)
I-176: ¹H-NMR(300.2 MHz, CDCl3):
δ = 8.1496 (5.0); 8.0688 (0.7); 7.6258 (0.6); 7.5998 (1.5); 7.5734 (1.2); 7.5092 (1.4); 7.4835 (0.8);
7.4032 (1.7); 7.3717 (2.6); 7.3450 (2.7); 7.2987 (5.7); 7.0660 (1.9); 6.9800 (1.0); 6.9535 (0.9); 6.9145
(1.1); 6.7268 (2.2); 6.5391 (1.1); 4.3061 (1.0); 4.2863 (1.0); 4.2580 (2.2); 4.2382 (2.1); 4.2099 (1.1);
4.1901 (1.1); 4.1714 (0.6); 4.1476 (0.6); 2.7536 (16.0); 2.5191 (3.2); 2.5120 (5.9); 2.5046 (3.2);
2.3149 (8.0); 2.0826 (2.6); 1.6068 (2.3); 1.3210 (0.7); 1.2971 (1.6); 1.2733 (0.7); 0.0384 (7.0)
I-177: ¹H-NMR(400.1 MHz, CDCl3):
δ = 7.9869 (0.5); 7.5423 (0.5); 7.5225 (2.3); 7.5073 (5.9); 7.4239 (3.0); 7.4017 (0.5); 7.3974 (0.4);
7.3890 (1.3); 7.3821 (2.2); 7.3767 (1.7); 7.3659 (1.6); 7.3505 (3.8); 7.3263 (3.1); 7.3228 (3.1); 7.3038
(2.7); 7.2851 (1.4); 7.2598 (20.7); 6.4753 (0.8); 6.4599 (1.3); 6.4447 (0.7); 4.3815 (1.8); 4.3641 (5.7);
4.3466 (5.8); 4.3292 (1.8); 4.1971 (1.4); 4.1815 (1.4); 4.1601 (2.9); 4.1445 (2.8); 4.1230 (1.5); 4.1074
(1.4); 2.9479 (3.6); 2.8663 (3.2); 2.4158 (0.7); 2.3841 (0.5); 2.3653 (16.0); 1.5489 (27.9); 1.4471
(5.9); 1.4296 (11.8); 1.4122 (5.8); 1.3961 (0.5); −0.0002 (5.8)
I-178: ¹H-NMR(300.2 MHz, CDCl3):
δ = 8.2807 (4.5); 8.0898 (0.4); 8.0704 (0.7); 8.0507 (0.4); 7.6673 (1.8); 7.5729 (0.8); 7.5468 (2.0);
7.5204 (1.5); 7.5034 (1.3); 7.4752 (2.8); 7.4626 (1.6); 7.4368 (2.3); 7.4088 (0.6); 7.4036 (0.6); 7.2993
(12.7); 7.1599 (0.9); 7.1539 (0.9); 7.1331 (0.8); 7.1276 (0.8); 5.3387 (1.2); 5.1788 (2.1); 5.1585 (2.5);
5.1514 (2.4); 5.1310 (2.5); 4.8374 (2.3); 4.8162 (4.3); 4.7953 (2.3); 4.4871 (0.8); 4.4665 (0.8); 4.4388
(1.8); 4.4184 (1.7); 4.3908 (0.9); 4.3704 (0.9); 4.3248 (0.6); 4.3203 (0.6); 4.2976 (1.0); 4.2755 (0.5);
4.2709 (0.5); 1.5999 (16.0); 0.1069 (1.4); 0.0469 (0.5); 0.0373 (12.0); 0.0266 (0.5)
I-179: ¹H-NMR(499.9 MHz, CDCl3):
δ = 8.0565 (5.7); 7.9632 (0.7); 7.9519 (1.1); 7.9405 (0.6); 7.6221 (2.8); 7.4657 (1.4); 7.4644 (1.4);
7.4496 (1.9); 7.4483 (2.0); 7.4388 (1.9); 7.4218 (3.7); 7.3949 (2.2); 7.3918 (2.2); 7.3777 (1.3); 7.3717
(2.4); 7.3676 (3.2); 7.3637 (2.1); 7.3579 (1.9); 7.3415 (3.1); 7.3253 (1.6); 7.2669 (1.2); 7.1463 (1.6);
7.1433 (1.5); 7.1299 (1.3); 7.1269 (1.3); 4.4183 (1.1); 4.4060 (1.1); 4.3897 (2.3); 4.3773 (2.2); 4.3610
(1.2); 4.3487 (1.1); 2.7086 (16.0); 2.0409 (1.0); 1.6830 (0.6); 1.2566 (0.6); −0.0002 (1.2)
I-180: ¹H-NMR(400.0 MHz, CD3CN):
δ = 7.8047 (0.9); 7.7539 (7.5); 7.6864 (0.8); 7.6667 (2.4); 7.6471 (2.3); 7.6322 (2.9); 7.6127 (1.1);
7.5321 (3.2); 7.4593 (1.9); 7.4397 (1.5); 7.3321 (2.9); 7.3122 (3.1); 7.0607 (4.0); 6.9459 (1.9); 6.9261
(1.7); 4.1873 (1.6); 4.1711 (1.6); 4.1515 (3.3); 4.1354 (3.2); 4.1157 (1.7); 4.0996 (1.6); 3.8426 (3.6);
3.6402 (0.9); 3.1357 (0.4); 3.1197 (0.4); 2.4413 (9.6); 2.2787 (0.7); 2.2660 (1.0); 2.2578 (1.2); 2.2453
(2.0); 2.2317 (14.3); 2.2127 (0.8); 2.1577 (16.6); 2.1417 (17.5); 1.9714 (0.6); 1.9633 (0.6); 1.9516
(7.4); 1.9455 (13.6); 1.9394 (18.7); 1.9332 (13.2); 1.9271 (7.0); 1.7429 (0.4); 1.7309 (0.5); 1.7171
(0.5); 1.6699 (0.4); 1.6578 (0.5); 1.6443 (0.4); 1.4356 (16.0); 1.2724 (0.5); 1.2553 (0.4); 1.2194 (0.6);
1.2102 (1.6); 1.2034 (0.9); 1.1930 (1.6); 1.1145 (0.7); 1.1100 (0.7); 1.1019 (2.0); 1.0955 (3.4); 1.0879
(1.9); 1.0810 (2.3); 1.0750 (3.0); 1.0674 (1.8); 1.0546 (0.7); 1.0461 (1.6); 1.0375 (3.6); 1.0330 (3.4);
1.0260 (3.4); 1.0198 (2.7); 1.0071 (0.8); 0.9215 (0.3); 0.9048 (0.4); −0.0002 (9.2)
I-181: ¹H-NMR(400.1 MHz, CDCl3):
δ = 7.9885 (1.3); 7.5438 (0.7); 7.5242 (2.9); 7.5080 (7.9); 7.4929 (0.7); 7.4353 (4.0); 7.4080 (0.5);
7.3943 (1.7); 7.3880 (2.7); 7.3825 (2.0); 7.3711 (2.0); 7.3621 (3.7); 7.3419 (3.8); 7.2599 (23.8);
7.0818 (0.4); 7.0503 (4.2); 6.9890 (2.3); 6.9690 (2.0); 6.5176 (1.0); 6.5027 (1.8); 6.4880 (1.0); 4.5058
(0.3); 4.4882 (0.3); 4.3845 (2.4); 4.3670 (7.5); 4.3496 (7.6); 4.3321 (2.4); 4.2272 (1.7); 4.2115 (1.7);
4.1899 (3.7); 4.1743 (3.5); 4.1527 (1.9); 4.1370 (1.7); 2.9483 (9.3); 2.8677 (8.2); 2.4788 (11.8);
2.3487 (0.7); 2.3257 (0.5); 2.2972 (16.0); 1.5530 (28.3); 1.5169 (0.3); 1.4487 (7.7); 1.4313 (15.4);
1.4138 (7.5); 1.3984 (0.7); 1.3807 (0.4); −0.0002 (7.0)
I-182: ¹H-NMR(400.1 MHz, d₆-DMSO):
δ = 9.1604 (3.1); 8.0338 (16.0); 7.9610 (0.6); 7.6695 (2.0); 7.6497 (4.7); 7.6299 (3.3); 7.5888 (6.4);
7.5676 (11.1); 7.5400 (4.4); 7.5117 (11.8); 7.4902 (7.0); 7.4657 (6.0); 7.4219 (3.4); 7.4015 (2.9);
7.2465 (2.7); 7.1073 (5.9); 6.9681 (2.9); 4.1496 (1.4); 4.1361 (1.6); 4.1151 (3.2); 4.1013 (3.2); 4.0803
(1.9); 4.0666 (1.7); 3.3119 (34.8); 2.8986 (3.6); 2.7399 (3.3); 2.5131 (13.7); 2.5088 (18.4); 2.5046 (14.0)
I-183: ¹H-NMR(300.2 MHz, CDCl3):
δ = 8.7255 (5.4); 7.6072 (0.4); 7.5808 (2.0); 7.5719 (1.9); 7.5618 (4.8); 7.5588 (4.5); 7.5329 (2.6);
7.5043 (3.3); 7.4965 (2.7); 7.4929 (2.5); 7.4904 (2.5); 7.4752 (0.4); 7.4173 (2.4); 7.3953 (0.4); 7.3800
(1.1); 7.3689 (1.4); 7.3619 (1.3); 7.3492 (1.1); 7.3415 (0.6); 7.2986 (1.5); 7.1846 (2.1); 7.1784 (2.1);
7.1571 (2.2); 7.1501 (1.7); 7.1412 (0.8); 4.4198 (1.0); 4.3985 (1.0); 4.3717 (2.1); 4.3504 (2.1); 4.3235
(1.1); 4.3022 (1.0); 2.3096 (16.0); 2.2837 (1.0); 1.7875 (0.6); 1.2912 (0.4); 0.0328 (1.4)
I-184: ¹H-NMR(400.0 MHz, d₆-DMSO):
δ = 9.0414 (1.2); 9.0214 (1.2); 7.9532 (0.5); 7.7818 (6.2); 7.7216 (0.6); 7.7014 (1.7); 7.6810 (1.4);
7.6414 (2.9); 7.6355 (2.6); 7.6298 (2.0); 7.5670 (1.3); 7.5468 (1.0); 6.9734 (3.0); 6.9694 (3.3); 6.8683
(1.1); 6.8646 (1.0); 6.8482 (2.1); 6.8442 (2.1); 6.8093 (4.3); 6.7893 (2.2); 5.9561 (3.9); 5.9539 (5.4);
5.9451 (5.0); 5.9429 (4.4); 5.0732 (0.8); 5.0547 (1.2); 5.0363 (0.8); 3.3536 (18.8); 3.3480 (20.0);
2.8908 (3.7); 2.7324 (3.2); 2.6043 (16.0); 2.5130 (5.3); 2.5086 (11.2); 2.5041 (15.0); 2.4995 (10.8);
2.4951 (5.2); 1.4067 (6.1); 1.3893 (6.0); −0.0002 (0.3)
I-185: ¹H-NMR(300.2 MHz, CDCl3):
δ = 8.3113 (9.3); 8.1070 (0.7); 8.0894 (1.1); 8.0705 (0.7); 7.5727 (1.5); 7.5466 (3.8); 7.5202 (2.8);
7.4553 (5.0); 7.4279 (7.9); 7.2989 (14.4); 7.2313 (2.5); 7.2243 (2.2); 7.2035 (1.8); 7.1966 (1.9);
7.1769 (1.7); 7.1737 (1.8); 7.1691 (1.6); 7.1659 (1.5); 7.1502 (1.5); 7.1469 (1.5); 7.1424 (1.4); 7.1392
(1.2); 6.1397 (0.8); 6.1290 (0.8); 6.1164 (0.8); 6.1057 (0.8); 5.9845 (0.8); 5.9740 (0.8); 5.9613 (0.8);
5.9507 (0.8); 5.3371 (3.1); 5.1756 (4.0); 5.1553 (4.8); 5.1480 (4.6); 5.1277 (4.8); 4.8371 (2.6); 4.8316
(2.6); 4.8160 (4.6); 4.8106 (4.6); 4.7950 (2.5); 4.7895 (2.4); 4.3588 (0.5); 4.3465 (0.7); 4.3364 (0.6);
4.3234 (1.3); 4.3175 (1.1); 4.3102 (0.8); 4.2955 (2.0); 4.2887 (1.1); 4.2699 (1.3); 4.2594 (0.6); 4.2472
(0.8); 4.2367 (0.5); 4.2212 (0.6); 4.2104 (0.5); 4.1988 (0.6); 4.1881 (0.5); 3.9036 (0.5); 3.8868 (0.6);
3.8804 (0.6); 3.8634 (0.6); 3.8550 (0.5); 3.8375 (0.6); 3.8317 (1.0); 3.8148 (1.0); 3.8088 (0.6); 3.7916
(0.6); 3.7831 (0.5); 3.7661 (0.5); 3.7598 (0.5); 3.7428 (0.4); 1.6152 (16.0); 1.2907 (0.3); 0.1066 (4.9);
0.0469 (0.5); 0.0363 (12.0); 0.0254 (0.5)
I-186: ¹H-NMR(300.2 MHz, CDCl3):
δ = 7.5591 (1.1); 7.5369 (3.4); 7.5151 (0.4); 7.4789 (1.6); 7.4440 (0.8); 7.4350 (1.2); 7.4276 (0.8);
7.4190 (1.9); 7.4056 (0.5); 7.3922 (1.7); 7.3164 (0.5); 7.2984 (10.3); 7.2772 (0.5); 7.0800 (1.7);
7.0266 (0.9); 7.0003 (0.8); 5.3374 (0.4); 5.1145 (0.4); 5.1063 (0.5); 5.0931 (0.5); 5.0852 (0.6); 5.0801
(0.5); 5.0668 (0.5); 5.0586 (0.4); 4.2888 (0.4); 4.2678 (0.4); 4.2355 (0.7); 4.2142 (0.7); 4.1847 (0.6);
4.1645 (0.8); 4.1312 (0.4); 4.1112 (0.4); 3.7565 (1.0); 3.7300 (1.0); 3.7196 (1.3); 3.6931 (1.2); 3.4962
(1.2); 3.4877 (1.3); 3.4593 (1.0); 3.4509 (0.9); 3.4197 (0.3); 3.4109 (0.3); 3.3444 (16.0); 2.5297 (5.0);
2.5225 (2.9); 2.3066 (6.7); 2.0441 (10.0); 1.6074 (4.0); 1.4618 (6.4); 1.4405 (6.3); 0.0478 (0.4);
0.0371 (9.8); 0.0261 (0.4)
I-187: ¹H-NMR(300.2 MHz, CDCl3):
δ = 8.2772 (13.9); 8.0239 (0.8); 8.0060 (1.3); 7.9891 (0.8); 7.3858 (3.6); 7.3592 (4.1); 7.2985 (15.1);
7.1914 (0.8); 7.1637 (3.6); 7.1552 (2.7); 7.1429 (7.4); 7.1346 (2.5); 7.1273 (2.9); 7.1074 (0.9); 7.1001
(0.5); 7.0647 (3.8); 6.9806 (2.1); 6.9541 (1.8); 6.9253 (1.3); 6.9129 (1.3); 6.9039 (2.0); 6.8948 (2.0);
6.8785 (1.2); 6.8714 (1.1); 4.3034 (2.0); 4.2835 (2.0); 4.2560 (4.4); 4.2359 (4.2); 4.2084 (2.2); 4.1885
(2.1); 2.5212 (6.3); 2.5142 (11.7); 2.5066 (6.4); 2.3101 (16.0); 2.1942 (0.4); 2.1767 (0.9); 2.1656
(1.0); 2.1486 (1.9); 2.1315 (1.0); 2.1203 (1.0); 2.1026 (0.6); 1.5882 (7.2); 1.1174 (1.4); 1.1021 (3.6);
1.0953 (3.8); 1.0894 (2.0); 1.0804 (2.1); 1.0735 (3.8); 1.0669 (3.4); 1.0522 (1.8); 0.8535 (1.8); 0.8384
(4.2); 0.8323 (4.0); 0.8214 (3.7); 0.8159 (4.6); 0.7993 (1.4); 0.0498 (0.6); 0.0465 (0.4); 0.0390 (18.9);
0.0313 (0.5); 0.0281 (0.6)
I-188: ¹H-NMR(400.1 MHz, d₆-DMSO):
δ = 8.8469 (0.8); 8.8328 (1.6); 8.8187 (0.8); 7.9597 (2.2); 7.7449 (0.6); 7.7256 (1.9); 7.7060 (1.9);
7.6914 (2.4); 7.6721 (1.0); 7.5923 (2.6); 7.5341 (1.5); 7.5146 (1.3); 6.9382 (2.2); 6.9180 (2.6); 6.6562
(3.6); 6.6101 (2.7); 6.5899 (2.5); 3.8206 (16.0); 3.6089 (0.8); 3.5923 (2.2); 3.5769 (2.4); 3.5608 (1.0);
3.3391 (102.1); 2.9644 (1.6); 2.9474 (3.2); 2.9305 (1.6); 2.8975 (12.7); 2.7382 (11.6); 2.5092 (11.3);
2.5053 (8.7); 2.4163 (12.2); 2.2342 (14.2)
I-189: ¹H-NMR(300.2 MHz, CDCl3):
δ = 8.9343 (0.5); 7.6545 (1.2); 7.3850 (3.5); 7.3583 (4.0); 7.2987 (18.2); 7.1249 (0.9); 7.0984 (2.9);
7.0718 (9.7); 7.0636 (3.7); 7.0487 (2.0); 7.0427 (2.5); 7.0217 (1.0); 7.0156 (0.8); 6.9822 (2.1); 6.9560
(1.9); 6.8512 (1.3); 6.8432 (1.3); 6.8284 (2.3); 6.8219 (1.9); 6.8033 (1.2); 6.7973 (1.1); 5.0611 (0.5);
5.0403 (1.0); 5.0176 (1.6); 4.9996 (5.9); 4.9961 (5.6); 4.9789 (6.2); 4.9579 (2.1); 4.6461 (3.0); 4.6316
(4.6); 4.6258 (4.8); 4.6086 (2.5); 4.2570 (1.8); 4.2369 (1.7); 4.2094 (3.9); 4.1891 (3.8); 4.1616 (2.0);
4.1414 (1.9); 2.5208 (11.7); 2.5137 (6.7); 2.3230 (16.0); 2.1651 (0.4); 2.1477 (0.9); 2.1366 (1.0);
2.1195 (1.8); 2.1025 (1.1); 2.0914 (1.0); 2.0835 (0.8); 2.0738 (0.5); 1.5925 (14.5); 1.3458 (0.5);
1.3064 (3.3); 1.2741 (0.4); 1.0859 (1.3); 1.0705 (3.4); 1.0638 (3.8); 1.0490 (2.0); 1.0419 (3.7); 1.0353
(3.5); 1.0208 (1.7); 0.9429 (1.2); 0.9211 (3.8); 0.8978 (1.4); 0.8234 (1.7); 0.8083 (4.2); 0.8024 (4.1);
0.7914 (3.7); 0.7856 (4.5); 0.7693 (1.3); 0.1090 (0.6); 0.0499 (0.8); 0.0391 (22.3); 0.0282 (0.8)
I-190: ¹H-NMR(300.2 MHz, CDCl3):
δ = 8.1441 (2.4); 8.0166 (0.4); 7.5170 (0.4); 7.5137 (0.5); 7.5112 (0.5); 7.5080 (0.4); 7.4904 (0.6);
7.4871 (0.7); 7.4846 (0.8); 7.4814 (0.6); 7.4115 (0.8); 7.4046 (1.9); 7.3985 (0.8); 7.3766 (2.0); 7.3494
(1.5); 7.3038 (8.4); 7.2147 (0.6); 7.2115 (0.6); 7.2071 (0.6); 7.2040 (0.5); 7.1875 (0.5); 7.1844 (0.5);
7.1799 (0.4); 7.1768 (0.4); 7.0778 (1.0); 6.9985 (0.6); 6.9717 (0.5); 5.3428 (2.3); 4.3033 (0.5); 4.2835
(0.5); 4.2555 (1.0); 4.2356 (1.0); 4.2075 (0.5); 4.1877 (0.5); 2.7602 (7.6); 2.5163 (3.0); 2.5092 (1.7);
2.3382 (4.2); 2.0885 (0.7); 2.0508 (0.7); 1.6081 (16.0); 1.3021 (0.6); 0.1119 (0.4); 0.0422 (7.0)
I-191: ¹H-NMR(499.9 MHz, CDCl3):
δ = 8.1024 (5.1); 8.0138 (0.5); 7.8352 (1.0); 7.5941 (0.8); 7.5801 (1.5); 7.5689 (1.3); 7.5568 (1.6);
7.5422 (1.0); 7.3656 (1.1); 7.3487 (2.0); 7.3436 (2.6); 7.3275 (2.6); 7.2604 (4.3); 7.0233 (2.8); 6.9394
(1.5); 6.9235 (1.4); 4.2545 (1.1); 4.2426 (1.1); 4.2259 (2.3); 4.2140 (2.2); 4.1973 (1.2); 4.1854 (1.1);
2.9527 (3.1); 2.8804 (3.0); 2.7191 (16.0); 2.4769 (7.9); 2.2929 (0.4); 2.2570 (11.2); 2.1325 (0.4);
1.5894 (1.9); −0.0002 (3.8)
I-192: ¹H-NMR(400.1 MHz, CDCl3):
δ = 7.9952 (1.4); 7.6834 (0.7); 7.6424 (8.4); 7.5969 (0.4); 7.5661 (1.5); 7.5468 (5.4); 7.5295 (15.7);
7.4741 (6.6); 7.4527 (11.3); 7.4430 (8.0); 7.3769 (10.4); 7.3598 (6.8); 7.2599 (87.6); 6.9960 (0.4);
6.4446 (2.0); 6.4293 (3.5); 6.4151 (1.8); 4.6766 (0.3); 4.5385 (0.4); 4.5204 (0.8); 4.5034 (0.8); 4.4853
(0.4); 4.4086 (3.5); 4.3942 (6.8); 4.3773 (15.1); 4.3718 (9.0); 4.3598 (16.0); 4.3424 (5.4); 4.3344
(3.9); 4.3184 (3.4); 2.9510 (9.9); 2.8715 (9.2); 1.5439 (103.2); 1.5034 (0.6); 1.4686 (14.0); 1.4512
(27.8); 1.4337 (13.6); 1.4107 (1.8); 1.4021 (0.7); 1.3928 (0.9); 1.3726 (0.3); −0.0002 (25.5)
I-193: ¹H-NMR(300.2 MHz, CDCl3):
δ = 8.1140 (5.0); 7.8807 (0.4); 7.8608 (0.7); 7.8413 (0.4); 7.6673 (2.1); 7.6641 (2.2); 7.6324 (1.1);
7.6131 (1.6); 7.5908 (0.8); 7.5144 (1.4); 7.4861 (3.3); 7.4493 (1.8); 7.4434 (1.7); 7.4321 (0.9); 7.4211
(0.8); 7.4150 (0.8); 7.4044 (1.2); 7.3781 (0.5); 7.2983 (9.8); 4.5083 (1.0); 4.4875 (1.0); 4.4611 (2.1);
4.4403 (2.1); 4.4139 (1.1); 4.3931 (1.0); 2.7584 (16.0); 1.5960 (4.6); 1.2273 (0.7); 0.0473 (0.4);
0.0364 (10.1); 0.0255 (0.3)
I-194: ¹H-NMR(400.1 MHz, d₆-DMSO):
δ = 8.9942 (0.8); 8.9798 (1.6); 8.9651 (0.8); 7.7577 (3.4); 7.7373 (6.3); 7.6417 (1.0); 7.6220 (2.2);
7.6023 (1.4); 7.5314 (0.9); 7.5272 (0.9); 7.5103 (2.8); 7.5059 (3.4); 7.4902 (4.6); 7.4811 (1.6); 7.4693
(1.5); 7.4359 (2.6); 7.3976 (1.5); 7.3772 (1.3); 7.2304 (1.3); 7.0911 (2.7); 6.9519 (1.3); 6.0445 (0.5);
6.0322 (1.0); 6.0189 (0.6); 5.9288 (0.5); 5.9166 (1.0); 5.9036 (0.6); 3.8826 (0.8); 3.8705 (1.6); 3.8560
(1.0); 3.8298 (0.7); 3.8235 (0.7); 3.8143 (1.3); 3.7990 (0.8); 3.3116 (13.4); 2.8986 (1.1); 2.7397 (1.0);
2.6030 (16.0); 2.5131 (6.4); 2.5088 (8.6); 2.5046 (6.5)
I-195: ¹H-NMR(400.0 MHz, d₆-DMSO):
δ = 9.0301 (1.2); 9.0097 (1.3); 7.9524 (0.7); 7.7712 (5.7); 7.7285 (0.6); 7.7090 (1.6); 7.6895 (1.3);
7.6518 (4.5); 7.6322 (1.1); 7.5730 (1.4); 7.5540 (1.0); 7.2498 (2.5); 7.1024 (1.2); 7.0990 (1.2); 7.0819
(1.3); 7.0786 (1.4); 6.6523 (2.8); 6.6318 (2.6); 5.0833 (0.8); 5.0646 (1.2); 5.0463 (0.8); 4.4758 (2.1);
4.4542 (4.0); 4.4321 (2.4); 3.3640 (21.8); 3.3531 (26.5); 3.3509 (26.3); 3.0677 (0.4); 3.0500 (0.8);
3.0290 (1.3); 3.0191 (0.8); 3.0074 (0.7); 2.9971 (1.4); 2.9756 (0.7); 2.9581 (0.4); 2.8906 (4.8); 2.7318
(4.2); 2.6011 (16.0); 2.5124 (6.9); 2.5080 (14.9); 2.5035 (20.2); 2.4990 (14.8); 2.4946 (7.3); 1.4113
(6.1); 1.3939 (6.0); 1.2406 (0.4)
I-196: ¹H-NMR(300.2 MHz, CDCl3):
δ = 8.1857 (5.0); 8.0635 (0.4); 8.0452 (0.6); 8.0286 (0.4); 7.6619 (1.2); 7.6412 (3.6); 7.6247 (0.5);
7.5846 (2.1); 7.5431 (1.6); 7.4791 (0.7); 7.4700 (1.2); 7.4627 (0.8); 7.4570 (0.5); 7.4485 (0.8); 7.4412
(0.5); 7.4248 (0.3); 7.3967 (2.7); 7.3908 (4.9); 7.3616 (0.3); 7.2990 (8.8); 6.1314 (0.5); 6.1208 (0.5);
6.1076 (0.5); 6.0970 (0.5); 5.9759 (0.5); 5.9652 (0.5); 5.9520 (0.5); 5.9415 (0.5); 3.8814 (0.4); 3.8746
(0.3); 3.8577 (0.4); 3.8270 (0.5); 3.8100 (0.5); 3.8042 (0.3); 3.1100 (1.1); 3.0847 (3.4); 3.0594 (3.4);
3.0341 (1.2); 1.6122 (16.0); 1.4356 (3.8); 1.4104 (8.0); 1.3850 (3.7); 1.2948 (1.4); 0.9396 (0.4);
0.9180 (1.3); 0.8948 (0.5); 0.1065 (2.1); 0.0361 (7.5)
I-197: ¹H-NMR(499.9 MHz, CDCl3):
δ = 7.3380 (2.8); 7.3312 (1.4); 7.3221 (3.1); 7.3153 (1.5); 7.2593 (5.9); 7.0583 (0.5); 7.0456 (0.8);
7.0283 (8.5); 7.0181 (3.6); 7.0141 (5.5); 7.0020 (0.5); 6.9984 (0.6); 6.9612 (2.0); 6.9450 (2.2); 6.9283
(1.0); 6.7605 (1.4); 6.7553 (1.3); 6.7518 (1.2); 6.7471 (2.1); 6.7415 (1.8); 6.7286 (1.0); 5.2199 (0.3);
5.2103 (1.1); 5.2006 (1.1); 5.1910 (0.4); 5.0635 (0.8); 5.0539 (2.6); 5.0443 (2.7); 5.0347 (0.9); 4.3597
(0.4); 4.3529 (0.4); 4.3451 (0.5); 4.3383 (0.5); 4.3157 (0.4); 4.3059 (0.8); 4.3001 (1.1); 4.2954 (1.1);
4.2906 (1.2); 4.2846 (0.9); 4.2751 (0.5); 4.1835 (0.8); 4.1772 (0.9); 4.1709 (1.3); 4.1660 (1.6); 4.1608
(1.3); 4.1532 (1.2); 4.1475 (1.9); 4.1432 (1.8); 4.1347 (1.7); 4.1304 (2.3); 4.1172 (1.6); 4.1045 (0.9);
4.1004 (1.2); 4.0866 (0.5); 3.9612 (1.5); 3.9441 (2.5); 3.9293 (1.8); 3.8371 (1.9); 3.8282 (1.9); 3.8198
(1.5); 3.8108 (1.4); 3.6290 (0.6); 3.6196 (1.0); 3.6126 (0.9); 3.6024 (1.0); 3.5955 (1.4); 3.5891 (1.7);
3.5760 (1.0); 3.5718 (0.9); 3.5584 (0.7); 3.5425 (0.4); 3.5335 (0.4); 3.5275 (0.4); 3.5177 (0.4); 3.4598
(0.7); 3.4492 (1.2); 3.4385 (0.8); 3.4335 (0.7); 3.4224 (0.9); 3.4119 (0.5); 2.4612 (11.8); 2.3337 (0.4);
2.2958 (16.0); 2.0864 (0.5); 2.0760 (1.0); 2.0692 (1.2); 2.0591 (2.1); 2.0489 (1.3); 2.0423 (1.2);
2.0318 (0.6); 1.9975 (1.6); 1.4670 (10.5); 1.4574 (10.6); 1.3989 (4.4); 1.3892 (4.5); 1.2558 (0.6);
1.0057 (1.2); 0.9959 (3.7); 0.9927 (3.9); 0.9790 (3.7); 0.9759 (3.7); 0.9668 (1.4); 0.7506 (1.5); 0.7406
(4.7); 0.7386 (4.8); 0.7311 (4.2); 0.7281 (5.0); 0.7184 (1.3); 0.0713 (0.5); −0.0002 (4.4)
I-198: ¹H-NMR(300.2 MHz, CDCl3):
δ = 8.1464 (2.8); 8.0247 (0.4); 7.4645 (0.5); 7.4376 (1.4); 7.4107 (1.1); 7.3760 (1.0); 7.3624 (0.8);
7.3588 (1.0); 7.3560 (1.0); 7.3522 (1.4); 7.3355 (0.4); 7.3318 (0.5); 7.3293 (0.5); 7.3259 (0.4); 7.3042
(8.5); 7.2586 (0.8); 7.2516 (1.4); 7.2448 (0.8); 7.1694 (0.7); 7.1660 (0.7); 7.1619 (0.6); 7.1586 (0.5);
7.1426 (0.6); 7.1391 (0.6); 7.1350 (0.5); 7.1316 (0.4); 7.0778 (1.2); 6.9963 (0.6); 6.9701 (0.6); 5.3433
(0.6); 4.3047 (0.6); 4.2850 (0.5); 4.2568 (1.2); 4.2371 (1.2); 4.2089 (0.6); 4.1892 (0.6); 2.7610 (8.6);
2.5167 (3.3); 2.5094 (1.8); 2.3368 (4.6); 2.0511 (0.6); 1.6083 (16.0); 1.3097 (1.4); 0.9469 (0.5);
0.9248 (1.5); 0.9018 (0.6); 0.0427 (7.3)
I-199: ¹H-NMR(400.1 MHz, CDCl3):
δ = 7.5287 (0.5); 7.5089 (2.5); 7.4947 (5.9); 7.4039 (3.5); 7.3904 (1.5); 7.3826 (1.8); 7.3771 (1.4);
7.3678 (1.3); 7.2766 (4.5); 7.2594 (19.0); 7.1458 (4.9); 7.1261 (3.6); 6.3003 (1.3); 6.2802 (1.3);
5.3549 (0.4); 5.3371 (1.2); 5.3187 (1.7); 5.3003 (1.2); 4.3656 (0.3); 4.3482 (1.0); 4.3427 (0.8); 4.3306
(1.2); 4.3252 (2.1); 4.3075 (2.3); 4.2885 (2.3); 4.2709 (2.1); 4.2655 (1.1); 4.2534 (0.8); 4.2479 (0.9);
2.9454 (0.9); 2.8652 (0.8); 2.3509 (0.8); 2.3265 (16.0); 2.2823 (0.8); 1.6098 (9.3); 1.5925 (9.2);
1.5483 (19.0); 1.5244 (0.5); 1.4948 (0.4); 1.4071 (0.4); 1.3890 (0.4); 1.3755 (5.7); 1.3580 (11.4);
1.3406 (5.5); −0.0002 (4.6)
I-200: ¹H-NMR(300.2 MHz, CDCl3):
δ = 8.1133 (5.2); 7.8800 (0.4); 7.8605 (0.7); 7.8416 (0.4); 7.6515 (0.6); 7.6436 (0.8); 7.6288 (1.1);
7.6259 (1.1); 7.6149 (1.4); 7.6050 (0.9); 7.5913 (1.0); 7.5847 (2.3); 7.5562 (2.4); 7.5111 (1.8); 7.5075
(1.8); 7.5047 (1.9); 7.4300 (0.8); 7.4021 (1.2); 7.3740 (0.5); 7.2985 (8.7); 7.2890 (1.3); 7.2674 (1.0);
7.2606 (1.0); 4.5113 (1.0); 4.4905 (1.0); 4.4641 (2.2); 4.4434 (2.1); 4.4170 (1.1); 4.3962 (1.0); 2.7572
(16.0); 1.6050 (1.3); 1.2272 (0.6); 0.0364 (8.4)
I-201: ¹H-NMR(300.2 MHz, CDCl3):
δ = 8.9353 (6.0); 8.9235 (0.4); 7.9265 (0.5); 7.9078 (0.8); 7.8901 (0.5); 7.6931 (0.4); 7.6671 (1.5);
7.6452 (4.3); 7.6294 (0.5); 7.5775 (2.6); 7.5754 (2.5); 7.5485 (2.0); 7.4883 (0.9); 7.4799 (1.4); 7.4726
(1.0); 7.4689 (0.8); 7.4584 (1.1); 7.4508 (0.6); 7.3874 (7.0); 7.2987 (5.1); 6.1291 (0.6); 6.1183 (0.7);
6.1054 (0.6); 6.0945 (0.6); 5.9736 (0.6); 5.9627 (0.7); 5.9498 (0.7); 5.9390 (0.6); 5.8366 (3.2); 4.3107
(0.4); 4.2997 (0.4); 4.2883 (0.4); 4.2774 (0.4); 4.2687 (0.3); 4.2199 (0.4); 4.2088 (0.4); 4.1975 (0.4);
4.1867 (0.3); 3.8980 (0.3); 3.8809 (0.4); 3.8742 (0.4); 3.8570 (0.5); 3.8494 (0.4); 3.8321 (0.5); 3.8275
(0.6); 3.8104 (0.6); 3.7872 (0.4); 3.7793 (0.3); 2.3237 (16.0); 2.0413 (0.5); 1.6246 (0.9); 0.0363 (4.5)
I-202: ¹H-NMR(400.1 MHz, d₆-DMSO):
δ = 9.1748 (2.4); 9.1592 (5.2); 9.1439 (2.4); 7.9608 (1.5); 7.6801 (2.1); 7.6605 (5.8); 7.6409 (4.6);
7.6090 (6.2); 7.5896 (3.2); 7.5718 (0.4); 7.5529 (9.8); 7.5314 (13.2); 7.4184 (8.5); 7.4071 (16.0);
7.3860 (13.0); 5.8159 (7.7); 5.8019 (7.9); 4.6007 (3.0); 4.5834 (4.8); 4.5602 (4.2); 4.4935 (0.6);
4.4673 (2.6); 4.4533 (2.3); 4.4422 (1.3); 4.4251 (0.5); 4.1391 (5.8); 4.1299 (6.9); 4.1093 (7.9); 4.0944
(4.8); 4.0731 (2.4); 4.0575 (2.2); 3.3121 (159.6); 2.8990 (9.6); 2.7399 (8.7); 2.5135 (28.4); 2.5091
(39.0); 2.5048 (29.2)
I-203: ¹H-NMR(400.1 MHz, d₆-DMSO):
δ = 9.1068 (1.2); 9.0922 (2.5); 9.0779 (1.2); 8.0613 (11.4); 7.9607 (0.4); 7.7585 (5.5); 7.6685 (1.4);
7.6488 (3.4); 7.6291 (2.3); 7.5368 (3.0); 7.5168 (2.6); 7.4915 (16.0); 7.4710 (0.8); 7.4480 (2.4);
7.4278 (2.0); 7.2430 (2.0); 7.1037 (4.2); 6.9646 (2.1); 6.0499 (0.9); 6.0370 (1.8); 6.0248 (0.9); 5.9347
(0.9); 5.9218 (1.9); 5.9093 (0.9); 3.8975 (1.5); 3.8835 (2.5); 3.8703 (1.4); 3.8394 (1.6); 3.8256 (2.6);
3.8121 (1.4); 3.3114 (23.7); 2.8986 (2.5); 2.7397 (2.3); 2.5130 (10.6); 2.5087 (14.2); 2.5045 (10.7)
I-204: ¹H-NMR(300.2 MHz, CDCl3):
δ = 7.5549 (0.7); 7.5286 (1.7); 7.4982 (3.0); 7.4691 (4.0); 7.4407 (1.5); 7.4149 (1.0); 7.3903 (3.8);
7.3623 (2.2); 7.3124 (1.9); 7.2983 (3.7); 7.2866 (1.1); 7.2834 (1.2); 7.2800 (0.9); 7.2600 (0.8); 7.2567
(0.9); 7.2527 (0.8); 7.0731 (0.5); 7.0523 (1.1); 7.0313 (0.5); 6.8659 (1.1); 6.6782 (2.3); 6.4906 (1.2);
4.1864 (0.9); 4.1654 (0.8); 4.1389 (1.9); 4.1179 (1.8); 4.0914 (0.9); 4.0704 (0.9); 2.2769 (16.0);
1.6432 (4.2); 1.2921 (0.8); 0.9177 (0.4); 0.0358 (3.5)
I-205: ¹H-NMR(400.0 MHz, d₆-DMSO):
δ = 9.0585 (1.3); 9.0381 (1.3); 7.7720 (6.1); 7.7301 (0.6); 7.7103 (1.7); 7.6910 (1.4); 7.6576 (3.6);
7.6358 (1.0); 7.5841 (1.4); 7.5646 (1.0); 7.1422 (2.5); 7.0959 (0.9); 7.0764 (1.7); 7.0728 (1.7); 7.0337
(2.6); 7.0141 (1.4); 5.0822 (0.8); 5.0637 (1.1); 5.0454 (0.8); 3.3628 (27.9); 3.3529 (39.6); 2.8905
(1.3); 2.7320 (1.1); 2.6016 (16.0); 2.5125 (7.2); 2.5081 (15.5); 2.5036 (21.0); 2.4990 (15.2); 2.4946
(7.4); 2.1451 (11.4); 2.0714 (11.9); 1.4126 (6.1); 1.3952 (6.1); −0.0002 (0.4)
I-206: ¹H-NMR(400.2 MHz, d₆-DMSO):
δ = 9.1362 (1.4); 9.1161 (1.5); 7.8091 (6.7); 7.7325 (0.6); 7.7126 (1.9); 7.6929 (4.0); 7.6557 (2.0);
7.6361 (1.1); 7.6026 (1.5); 7.5846 (1.0); 7.5813 (1.0); 7.1784 (2.4); 7.1733 (2.9); 7.1338 (2.8); 7.1287
(2.3); 5.1990 (0.9); 5.1806 (1.3); 5.1619 (0.9); 4.5703 (1.4); 4.5606 (1.0); 4.5480 (2.4); 4.5391 (2.4);
4.5262 (1.2); 4.5171 (1.4); 3.3328 (44.4); 3.1839 (1.6); 3.1620 (3.0); 3.1403 (1.5); 2.8923 (0.4);
2.7335 (0.3); 2.6100 (16.0); 2.5121 (13.6); 2.5081 (25.7); 2.5036 (33.0); 2.4990 (24.3); 2.4947 (12.4);
1.3867 (6.3); 1.3692 (6.3); 1.2405 (0.6)
I-207: ¹H-NMR(400.2 MHz, d₆-DMSO):
δ = 20.0124 (0.4); 10.0224 (0.4); 9.3809 (1.0); 9.3655 (2.3); 9.3488 (1.0); 9.0570 (0.4); 8.3155 (10.9);
8.1369 (0.6); 7.7526 (1.1); 7.7323 (2.9); 7.7130 (2.5); 7.6917 (3.5); 7.6698 (1.5); 7.6192 (0.5); 7.5873
(4.1); 7.5643 (2.4); 7.5447 (2.0); 7.3534 (3.0); 7.3336 (3.4); 7.3038 (1.1); 7.2871 (0.7); 7.1044 (4.2);
7.0546 (0.9); 6.9787 (0.4); 6.9608 (1.9); 6.9424 (1.8); 6.8147 (0.5); 6.7975 (0.4); 5.8126 (0.5); 5.7938
(1.1); 5.7760 (0.6); 4.6906 (0.5); 4.6189 (0.6); 4.5999 (1.3); 4.5812 (0.7); 4.1825 (0.9); 4.1680 (0.9);
4.1454 (1.9); 4.1300 (1.9); 4.1059 (1.1); 4.0909 (1.1); 3.9846 (2.2); 3.9732 (2.3); 3.9557 (2.6); 3.9448
(2.4); 3.8761 (0.4); 3.7812 (0.6); 3.7535 (0.6); 3.7345 (0.6); 3.5993 (0.4); 3.5345 (0.6); 3.5147 (1.0);
3.5077 (0.9); 3.4802 (1.0); 3.4613 (0.8); 3.3370 (3221.7); 3.3038 (12.7); 3.2515 (4.9); 3.2335 (0.9);
3.1956 (1.4); 3.1672 (0.9); 2.7913 (0.4); 2.7825 (0.4); 2.6807 (9.8); 2.6763 (13.3); 2.6717 (9.8);
2.5466 (17.0); 2.5294 (50.5); 2.5160 (868.8); 2.5118 (1671.2); 2.5073 (2151.6); 2.5027 (1564.0);
2.4984 (767.0); 2.4315 (11.8); 2.3385 (9.7); 2.3340 (13.1); 2.3296 (9.5); 2.2824 (1.7); 2.2723 (1.1);
2.2470 (16.0); 2.2247 (2.4); 2.2069 (4.7); 2.2015 (3.3); 2.0772 (15.9); 1.5880 (2.2); 1.5613 (2.0);
1.3970 (0.5); 1.3308 (0.4); 1.2386 (0.5); 0.0044 (1.7)
I-208: ¹H-NMR(400.0 MHz, CD3CN):
δ = 8.0396 (16.0); 7.6707 (0.8); 7.6510 (3.7); 7.6349 (10.5); 7.6184 (0.8); 7.5355 (1.1); 7.5162 (5.0);
7.4333 (0.3); 7.4195 (1.7); 7.4131 (3.3); 7.4078 (2.2); 7.4021 (1.3); 7.3970 (2.1); 7.3913 (1.4); 6.9561
(3.0); 6.9371 (4.7); 6.8766 (3.8); 6.8566 (9.0); 5.4461 (3.2); 4.4261 (0.4); 4.4182 (0.5); 4.4136 (0.6);
4.4061 (1.4); 4.3987 (1.2); 4.3944 (1.3); 4.3858 (2.0); 4.3772 (1.3); 4.3730 (1.3); 4.3655 (1.4); 4.3579
(0.5); 4.3534 (0.5); 4.3456 (0.4); 3.0961 (1.5); 3.0842 (1.5); 3.0557 (2.0); 3.0436 (1.9); 2.8693 (3.6);
2.8526 (7.0); 2.8359 (3.7); 2.7972 (2.0); 2.7776 (1.9); 2.7568 (1.5); 2.7375 (1.5); 2.4618 (0.3); 2.1843
(26.2); 2.1478 (48.9); 2.1188 (0.4); 2.1126 (0.6); 2.1064 (1.1); 2.1002 (0.8); 2.0952 (0.7); 2.0905
(1.0); 2.0878 (1.1); 2.0827 (1.1); 2.0800 (1.1); 2.0739 (1.3); 2.0716 (1.3); 2.0663 (1.3); 2.0638 (1.3);
2.0581 (1.6); 2.0555 (1.6); 2.0503 (1.6); 2.0478 (1.5); 2.0422 (0.8); 2.0345 (0.7); 1.9677 (1.5); 1.9633
(3.2); 1.9572 (8.3); 1.9514 (42.0); 1.9453 (73.3); 1.9391 (96.6); 1.9329 (67.7); 1.9267 (34.6); 1.9136
(1.5); 1.8970 (1.3); 1.8785 (0.5); 1.7737 (0.4); 1.7675 (0.6); 1.7614 (0.4); 1.2849 (0.3); 1.2699 (0.7);
1.0834 (0.5); 0.8808 (0.5); 0.1461 (0.4); 0.0078 (4.2); −0.0003 (98.5); −0.0085 (3.8); −0.1496 (0.4)
I-209: ¹H-NMR(400.1 MHz, CDCl3):
δ = 8.2518 (9.6); 8.0159 (0.4); 7.7993 (1.4); 7.4301 (1.2); 7.4260 (1.3); 7.4094 (2.4); 7.3947 (1.4);
7.3898 (1.4); 7.3364 (3.5); 7.3165 (3.8); 7.2594 (30.5); 7.2502 (3.2); 7.2460 (2.2); 7.2348 (2.3);
7.2297 (2.0); 7.2203 (2.7); 7.1994 (2.6); 7.1788 (1.0); 7.0305 (4.1); 6.9455 (2.2); 6.9253 (2.0); 4.2523
(1.8); 4.2373 (1.8); 4.2166 (3.7); 4.2018 (3.5); 4.1810 (1.9); 4.1660 (1.8); 2.9547 (3.0); 2.8824 (2.8);
2.4716 (11.5); 2.2759 (16.0); 2.1577 (0.4); 1.5436 (25.3); −0.0002 (1.5)
I-210: ¹H-NMR(400.0 MHz, d₆-DMSO):
δ = 8.6587 (2.9); 7.7285 (0.6); 7.7088 (1.8); 7.6891 (1.6); 7.6634 (2.0); 7.6462 (6.6); 7.5367 (2.5);
7.5110 (1.4); 7.4913 (1.1); 7.1231 (3.5); 7.1034 (4.2); 6.8923 (3.8); 6.8730 (3.2); 3.3269 (19.8);
2.8901 (0.9); 2.8626 (6.3); 2.7310 (0.8); 2.5640 (16.0); 2.5061 (18.6); 2.5017 (24.6); 2.4974 (18.0);
2.1415 (12.4); 1.2402 (0.6); 0.8456 (1.0); 0.8278 (3.4); 0.8168 (1.5); 0.7324 (1.4); 0.7213 (3.3);
0.7039 (0.9); −0.0002 (3.4)
I-211: ¹H-NMR(400.1 MHz, d₆-DMSO):
δ = 9.1988 (1.6); 9.1836 (3.5); 9.1680 (1.8); 7.9613 (2.4); 7.6843 (1.5); 7.6647 (4.0); 7.6448 (3.2);
7.6119 (4.2); 7.5924 (2.3); 7.5658 (6.6); 7.5444 (9.2); 7.4433 (5.5); 7.4293 (9.7); 7.4079 (8.1); 7.1077
(0.9); 7.0950 (2.6); 7.0821 (2.7); 7.0704 (1.0); 4.1666 (1.4); 4.1513 (1.5); 4.1306 (3.1); 4.1152 (3.0);
4.0941 (1.7); 4.0787 (1.6); 3.3121 (107.0); 2.8991 (16.0); 2.8008 (14.2); 2.7879 (14.5); 2.7402 (14.4);
2.5136 (18.7); 2.5092 (25.8); 2.5048 (19.5)
I-212: ¹H-NMR(400.1 MHz, d₆-DMSO):
δ = 9.1084 (1.7); 9.0940 (3.4); 9.0793 (1.7); 8.0638 (16.0); 7.9607 (2.4); 7.6669 (2.0); 7.6464 (9.8);
7.6275 (3.3); 7.5716 (5.5); 7.5506 (7.0); 7.5358 (4.2); 7.5166 (3.0); 7.4845 (5.7); 7.4479 (3.3); 7.4277
(2.8); 7.3831 (4.1); 7.3781 (4.0); 7.3622 (3.3); 7.3572 (3.3); 7.2414 (2.8); 7.1021 (5.9); 6.9629 (2.9);
6.0650 (1.2); 6.0522 (2.4); 6.0398 (1.2); 5.9494 (1.2); 5.9370 (2.5); 5.9244 (1.2); 3.9017 (2.2); 3.8879
(3.7); 3.8743 (2.1); 3.8438 (2.3); 3.8298 (3.8); 3.8163 (2.1); 3.3117 (32.2); 2.8985 (14.8); 2.7396
(13.4); 2.5130 (13.5); 2.5087 (18.0); 2.5045 (13.5)
I-213: ¹H-NMR(400.0 MHz, d₆-DMSO):
δ = 9.1937 (1.2); 9.1739 (1.2); 7.8043 (6.3); 7.7302 (0.6); 7.7104 (1.7); 7.6908 (1.4); 7.6631 (2.4);
7.6584 (2.8); 7.6346 (1.0); 7.5874 (1.4); 7.5682 (1.0); 7.4711 (2.7); 7.3716 (0.9); 7.3682 (0.6); 7.3562
(1.3); 7.3527 (2.2); 7.3377 (1.6); 7.3186 (3.0); 7.2999 (1.5); 7.2857 (1.4); 7.2813 (2.2); 7.2768 (1.3);
7.2665 (0.7); 7.2620 (1.0); 7.2577 (0.6); 5.1618 (0.8); 5.1434 (1.2); 5.1250 (0.8); 3.3663 (18.7);
3.3568 (28.2); 2.8914 (1.2); 2.7330 (1.0); 2.6102 (16.0); 2.5141 (5.5); 2.5097 (11.5); 2.5051 (15.4);
2.5006 (11.0); 2.4962 (5.3); 1.4448 (6.3); 1.4272 (6.3); −0.0002 (0.3)
I-214: ¹H-NMR(400.2 MHz, d₆-DMSO):
δ = 9.0162 (0.7); 9.0069 (0.8); 8.9961 (0.8); 8.9867 (0.8); 7.9526 (0.6); 7.7674 (6.6); 7.7264 (0.6);
7.7077 (1.5); 7.6864 (1.2); 7.6475 (4.3); 7.6286 (1.0); 7.5706 (1.4); 7.5528 (0.9); 7.2086 (2.3); 7.0893
(1.1); 7.0688 (1.2); 6.6117 (1.6); 6.6085 (1.7); 6.5913 (1.5); 6.5881 (1.6); 5.0780 (0.5); 5.0721 (0.5);
5.0558 (0.7); 5.0405 (0.5); 5.0349 (0.5); 4.8611 (0.4); 4.8448 (0.7); 4.8420 (0.8); 4.8263 (0.8); 4.8235
(0.7); 4.8072 (0.5); 3.3319 (26.9); 3.1977 (0.4); 3.1760 (0.4); 3.1575 (0.8); 3.1351 (0.7); 3.1164 (0.5);
3.0946 (0.4); 2.8918 (4.8); 2.7334 (4.0); 2.6671 (0.6); 2.6478 (0.5); 2.6275 (0.4); 2.6008 (16.0);
2.5825 (0.6); 2.5635 (0.5); 2.5430 (0.5); 2.5254 (0.8); 2.5210 (0.9); 2.5121 (10.2); 2.5076 (20.9);
2.5030 (27.4); 2.4984 (19.5); 2.4939 (9.3); 1.4096 (3.9); 1.4069 (4.0); 1.3923 (3.9); 1.3895 (3.9);
1.3322 (4.2); 1.3166 (4.7); 1.3127 (4.8); 1.2970 (4.3); 1.2408 (0.5)
I-215: ¹H-NMR(300.2 MHz, CDCl3):
δ = 7.3531 (2.4); 7.3460 (2.5); 7.2986 (8.2); 7.2264 (2.0); 7.1991 (2.5); 7.1525 (0.5); 7.1260 (1.4);
7.0992 (2.9); 7.0908 (1.4); 7.0758 (1.0); 7.0699 (1.2); 7.0490 (0.5); 7.0428 (0.4); 7.0020 (1.6); 6.9949
(1.5); 6.9746 (1.2); 6.9676 (1.2); 6.8696 (0.6); 6.8616 (0.6); 6.8466 (1.2); 6.8399 (1.0); 6.8216 (0.6);
6.8157 (0.5); 6.2262 (0.4); 6.2082 (0.7); 6.1896 (0.4); 5.3369 (1.1); 3.8782 (1.0); 3.8569 (2.5); 3.8352
(2.5); 3.8137 (1.1); 3.1285 (1.8); 3.1064 (3.2); 3.0845 (1.6); 2.4593 (16.0); 2.3015 (0.3); 2.1128 (0.4);
2.1013 (0.5); 2.0845 (0.9); 2.0674 (0.5); 2.0561 (0.5); 1.5942 (6.3); 1.0801 (0.6); 1.0647 (1.7); 1.0580
(1.9); 1.0432 (1.1); 1.0361 (1.9); 1.0296 (1.7); 1.0150 (0.9); 0.8220 (0.8); 0.8069 (2.1); 0.8010 (2.0);
0.7900 (1.9); 0.7844 (2.2); 0.7680 (0.7); 0.1076 (0.6); 0.0377 (7.1); 0.0268 (0.4)
I-216: ¹H-NMR(300.2 MHz, CDCl3):
δ = 8.4207 (8.4); 8.1695 (8.3); 7.6569 (0.3); 7.6306 (2.5); 7.6247 (2.2); 7.6200 (2.2); 7.6127 (6.3);
7.6093 (6.6); 7.5940 (0.5); 7.5196 (2.9); 7.5018 (0.5); 7.4948 (0.3); 7.4871 (1.3); 7.4751 (1.8); 7.4684
(1.5); 7.4569 (1.2); 7.4488 (0.7); 7.3284 (2.9); 7.2986 (23.0); 7.0485 (3.2); 6.9494 (1.8); 6.9235 (1.5);
6.6805 (0.8); 6.6604 (1.6); 6.6398 (0.8); 4.4252 (2.2); 4.4014 (7.2); 4.3777 (7.3); 4.3539 (2.3); 4.1493
(1.5); 4.1287 (1.5); 4.1009 (3.2); 4.0803 (3.1); 4.0524 (1.6); 4.0318 (1.6); 2.4588 (9.6); 2.4517 (5.4);
2.2979 (12.8); 1.6027 (14.4); 1.4393 (7.5); 1.4156 (16.0); 1.3918 (7.3); 1.2944 (0.5); 0.1083 (2.0);
0.0492 (0.8); 0.0383 (23.7); 0.0273 (0.8)
I-217: ¹H-NMR(400.2 MHz, d₆-DMSO):
δ = 9.2469 (0.7); 9.2319 (1.5); 9.2168 (0.7); 8.3167 (3.7); 7.7176 (0.8); 7.6981 (2.0); 7.6788 (1.5);
7.6445 (1.9); 7.6252 (1.0); 7.5400 (2.5); 7.5093 (1.4); 7.4894 (1.1); 7.3263 (2.3); 7.3061 (2.6); 7.0976
(2.7); 6.9748 (1.4); 6.9545 (1.2); 5.7954 (0.5); 4.6189 (0.3); 4.6002 (0.6); 4.1447 (0.8); 4.1304 (0.7);
4.1080 (1.6); 4.0921 (1.5); 4.0700 (0.8); 4.0545 (0.8); 3.8685 (0.3); 3.4049 (0.7); 3.3351 (765.0);
3.2773 (0.9); 3.2655 (0.7); 2.9207 (1.2); 2.9020 (3.9); 2.8832 (4.0); 2.8647 (1.3); 2.6809 (3.2); 2.6764
(4.3); 2.6718 (3.1); 2.6674 (1.5); 2.5466 (2.3); 2.5298 (14.1); 2.5250 (22.0); 2.5164 (265.4); 2.5120
(532.8); 2.5074 (697.8); 2.5028 (506.6); 2.4984 (246.3); 2.4362 (7.7); 2.4090 (0.4); 2.3433 (1.4);
2.3388 (3.1); 2.3342 (4.3); 2.3296 (3.0); 2.2495 (10.2); 2.1460 (16.0); 2.0778 (4.0); 1.2576 (4.8);
1.2390 (10.7); 1.2204 (4.7); 0.0045 (0.9)
I-218: ¹H-NMR(499.9 MHz, CDCl3):
δ = 8.0987 (5.1); 7.9717 (0.9); 7.4054 (1.1); 7.3892 (2.7); 7.3729 (1.8); 7.3259 (2.1); 7.3099 (3.6);
7.2939 (1.1); 7.2922 (1.2); 7.2906 (1.2); 7.2597 (13.7); 7.2113 (1.6); 7.2073 (2.7); 7.2032 (1.6);
7.1172 (1.3); 7.1156 (1.3); 7.1128 (1.3); 7.1009 (1.2); 7.0993 (1.2); 7.0965 (1.2); 7.0324 (2.5); 6.9465
(1.3); 6.9307 (1.3); 5.2977 (0.9); 4.2380 (1.0); 4.2262 (1.0); 4.2092 (2.2); 4.1974 (2.2); 4.1805 (1.1);
4.1687 (1.1); 2.7164 (16.0); 2.4721 (7.0); 2.2922 (10.0); 2.0035 (1.1); 1.5548 (25.3); 1.3027 (0.6);
1.2890 (0.8); 1.2657 (2.3); 1.2549 (1.7); 0.8957 (1.4); 0.8821 (3.2); 0.8679 (1.6); 0.0060
(0.5); −0.0002 (11.6)
I-219: ¹H-NMR(400.1 MHz, CDCl3):
δ = 8.1051 (5.3); 8.0178 (0.4); 7.8329 (0.8); 7.5984 (0.7); 7.5791 (1.6); 7.5590 (1.5); 7.5401 (0.9);
7.3709 (0.9); 7.3465 (2.7); 7.3261 (2.5); 7.2597 (26.0); 7.0239 (2.3); 6.9423 (1.2); 6.9217 (1.1);
4.2635 (1.0); 4.2486 (1.0); 4.2278 (2.2); 4.2129 (2.1); 4.1920 (1.1); 4.1771 (1.0); 2.9552 (2.8); 2.8829
(2.6); 2.7209 (16.0); 2.4775 (6.5); 2.2935 (0.4); 2.2578 (9.0); 1.5471 (15.3); −0.0002 (1.4)
I-220: ¹H-NMR(300.2 MHz, CDCl3):
δ = 8.6328 (11.8); 7.9198 (0.8); 7.9038 (1.4); 7.8858 (0.8); 7.7332 (6.6); 7.7161 (5.2); 7.6876 (0.4);
7.5464 (3.4); 7.5231 (0.3); 7.5107 (1.5); 7.5022 (1.5); 7.4920 (2.0); 7.4856 (1.6); 7.4804 (1.2); 7.4721
(0.9); 7.3793 (3.5); 7.3527 (4.0); 7.3040 (14.5); 7.0919 (3.9); 7.0049 (2.2); 6.9782 (1.9); 5.3433 (0.4);
4.3273 (1.9); 4.3075 (1.8); 4.2791 (4.0); 4.2593 (3.9); 4.2308 (2.0); 4.2111 (2.0); 2.5174 (11.7);
2.5102 (6.4); 2.3309 (16.0); 2.0884 (0.3); 1.5993 (13.9); 1.3327 (0.4); 1.3025 (0.4); 1.2884 (0.4);
0.1138 (0.4); 0.0539 (0.5); 0.0431 (13.4); 0.0322 (0.4)
I-221: ¹H-NMR(400.1 MHz, CDCl3):
δ = 7.9850 (0.6); 7.5515 (0.5); 7.5318 (2.3); 7.5166 (5.5); 7.4147 (2.8); 7.3663 (1.1); 7.3594 (1.7);
7.3538 (1.3); 7.3435 (1.2); 7.3379 (0.7); 7.2595 (13.1); 7.0273 (2.3); 7.0082 (3.0); 6.9624 (3.2);
6.8731 (1.8); 6.8545 (1.4); 6.1053 (0.7); 6.0918 (1.2); 6.0785 (0.7); 4.3658 (1.7); 4.3483 (5.4); 4.3308
(5.4); 4.3134 (1.7); 3.7641 (1.4); 3.7472 (3.6); 3.7317 (3.6); 3.7150 (1.5); 2.9474 (4.4); 2.9334 (2.5);
2.9163 (4.6); 2.8992 (2.2); 2.8684 (3.9); 2.3341 (0.7); 2.2880 (16.0); 2.2549 (14.6); 2.1909 (0.6);
1.5508 (13.8); 1.4420 (5.6); 1.4245 (11.1); 1.4070 (5.6); 1.3891 (0.5); −0.0002 (3.8)
I-222: ¹H-NMR(300.2 MHz, CDCl3):
δ = 8.5662 (8.2); 8.0482 (0.6); 8.0301 (1.1); 8.0117 (0.6); 7.6932 (0.3); 7.6668 (2.1); 7.6583 (1.8);
7.6478 (5.7); 7.6446 (4.8); 7.6326 (0.4); 7.5269 (2.7); 7.5012 (1.1); 7.4900 (1.5); 7.4829 (1.3); 7.4706
(1.1); 7.4629 (0.6); 7.3886 (2.5); 7.3621 (2.9); 7.3040 (11.0); 7.0814 (2.8); 6.9939 (1.6); 6.9667 (1.4);
5.9433 (4.3); 5.5523 (2.9); 5.5494 (2.9); 4.3318 (1.4); 4.3120 (1.3); 4.2836 (2.9); 4.2638 (2.8); 4.2355
(1.4); 4.2158 (1.4); 2.5292 (8.5); 2.5220 (4.7); 2.3340 (12.4); 2.3218 (12.3); 1.6060 (16.0); 0.0535
(0.4); 0.0427 (10.1); 0.0319 (0.4)
I-223: ¹H-NMR(300.2 MHz, CDCl3):
δ = 8.1613 (5.1); 7.9345 (0.6); 7.9155 (0.4); 7.6444 (0.6); 7.6209 (1.0); 7.6154 (1.1); 7.5859 (1.2);
7.5627 (0.7); 7.4189 (0.8); 7.3929 (1.3); 7.3652 (22.9); 7.2989 (15.1); 5.8332 (0.5); 5.8219 (0.6);
5.8077 (0.6); 5.7964 (0.6); 5.6743 (0.6); 5.6631 (0.6); 5.6489 (0.6); 5.6376 (0.6); 4.2184 (0.4); 4.2072
(0.4); 4.1959 (0.3); 4.1845 (0.4); 4.1264 (0.4); 4.1150 (0.4); 4.1039 (0.4); 4.0926 (0.4); 3.8866 (0.3);
3.8700 (0.4); 3.8613 (0.4); 3.8444 (0.4); 3.8224 (0.6); 3.8125 (0.4); 3.8060 (0.4); 3.7967 (0.5); 3.7804
(0.4); 3.2529 (0.3); 2.8413 (1.2); 2.7754 (16.0); 1.5936 (9.7); 1.2283 (1.1); 0.0482 (0.6); 0.0374
(15.0); 0.0266 (0.5)
I-224: ¹H-NMR(600.4 MHz, d₆-DMSO):
δ = 8.0623 (2.4); 7.7214 (0.5); 7.7081 (1.3); 7.7034 (4.4); 7.6950 (0.9); 7.6520 (1.0); 7.6390 (0.7);
7.5731 (1.4); 7.5445 (0.8); 7.5311 (0.7); 7.5278 (0.7); 7.5075 (0.4); 7.4932 (0.6); 7.4380 (0.7); 7.4239
(0.4); 7.2309 (2.1); 7.2279 (0.8); 7.2200 (1.0); 7.2169 (3.4); 7.2130 (0.5); 7.1733 (0.5); 7.1693 (3.8);
7.1660 (1.0); 7.1584 (0.8); 7.1553 (2.4); 5.7520 (0.4); 5.3952 (1.0); 3.3051 (90.1); 3.0744 (4.4);
2.6449 (2.1); 2.6150 (0.6); 2.6120 (0.9); 2.6089 (0.7); 2.5998 (11.4); 2.5210 (2.1); 2.5180 (2.5);
2.5148 (2.6); 2.5061 (49.0); 2.5031 (102.1); 2.5000 (137.6); 2.4970 (100.3); 2.4940 (47.4); 2.3870
(0.6); 2.3840 (0.8); 2.3809 (0.6); 1.2951 (16.0); −0.0002 (0.9)
I-225: ¹H-NMR(400.1 MHz, d₆-DMSO):
δ = 9.2467 (1.2); 9.2313 (2.6); 9.2156 (1.2); 7.9610 (2.4); 7.6902 (1.0); 7.6705 (2.9); 7.6508 (2.3);
7.6194 (3.0); 7.6000 (1.6); 7.5598 (4.9); 7.5384 (6.5); 7.4489 (3.9); 7.4288 (2.3); 7.4103 (8.0); 7.3893
(5.0); 6.4397 (1.2); 6.4261 (2.5); 6.4123 (1.2); 4.9757 (1.9); 4.9625 (4.3); 4.9493 (2.0); 4.1602 (1.0);
4.1442 (1.0); 4.1237 (2.2); 4.1083 (2.1); 4.0872 (1.2); 4.0719 (1.1); 3.5857 (1.5); 3.5719 (4.4); 3.5583
(4.6); 3.5447 (1.8); 3.3123 (86.8); 3.2727 (1.8); 3.2590 (4.4); 3.2450 (4.2); 3.2310 (1.4); 2.8989
(16.0); 2.7398 (14.3); 2.5133 (14.5); 2.5090 (19.8); 2.5046 (14.5)
I-226: ¹H-NMR(400.1 MHz, d₆-DMSO):
δ = 9.0798 (1.9); 9.0643 (4.0); 9.0488 (2.0); 7.9607 (0.4); 7.6861 (16.0); 7.6427 (2.3); 7.6229 (5.5);
7.6022 (10.9); 7.5807 (12.1); 7.5060 (15.6); 7.4847 (11.3); 7.4233 (6.5); 7.3787 (3.8); 7.3584 (3.1);
7.2332 (3.2); 7.0938 (6.8); 6.9545 (3.4); 4.1323 (2.0); 4.1166 (2.2); 4.0972 (4.5); 4.0816 (4.4); 4.0622
(2.4); 4.0465 (2.2); 3.3141 (87.3); 2.8984 (2.4); 2.7397 (2.2); 2.5966 (40.8); 2.5130 (16.2); 2.5088
(21.5); 2.5045 (16.0)
I-227: ¹H-NMR(400.0 MHz, d₆-DMSO):
δ = 9.2166 (1.2); 9.1971 (1.3); 7.9550 (0.6); 7.8076 (6.4); 7.7326 (0.6); 7.7130 (1.5); 7.6921 (1.3);
7.6547 (7.1); 7.6499 (4.4); 7.6385 (1.1); 7.5824 (1.4); 7.5620 (3.9); 7.5412 (3.9); 7.4065 (1.7); 7.4015
(1.7); 7.3855 (1.3); 7.3804 (1.3); 5.1534 (0.8); 5.1353 (1.2); 5.1171 (0.8); 3.3835 (25.7); 3.3787
(39.2); 3.3743 (46.6); 2.8936 (4.0); 2.7348 (3.5); 2.6115 (16.0); 2.5171 (5.4); 2.5126 (11.6); 2.5081
(15.7); 2.5035 (11.4); 2.4990 (5.5); 1.4416 (6.1); 1.4241 (6.0)
I-228: ¹H-NMR(300.2 MHz, CDCl3):
δ = 8.4710 (16.0); 8.4403 (6.2); 8.1265 (1.0); 8.1086 (1.7); 8.0879 (1.1); 7.7601 (5.6); 7.7205 (3.5);
7.7012 (9.4); 7.6979 (8.6); 7.6854 (1.4); 7.6446 (0.3); 7.6042 (5.7); 7.6003 (4.0); 7.5776 (4.2); 7.5369
(0.6); 7.5304 (0.5); 7.5208 (1.8); 7.5105 (2.8); 7.5033 (2.4); 7.4901 (2.4); 7.4820 (1.9); 7.4754 (0.8);
7.4449 (1.2); 7.4395 (1.0); 7.4170 (6.3); 7.4115 (6.8); 7.4045 (9.0); 7.3769 (1.7); 7.3064 (6.2); 7.2988
(34.3); 7.2250 (0.4); 7.2185 (0.3); 7.1644 (0.5); 6.1562 (1.1); 6.1458 (1.3); 6.1323 (1.3); 6.1219 (1.2);
6.0008 (1.1); 5.9904 (1.2); 5.9770 (1.3); 5.9665 (1.2); 4.4019 (0.6); 4.3914 (0.6); 4.3793 (0.6); 4.3688
(0.6); 4.3531 (0.7); 4.3427 (0.8); 4.3305 (0.7); 4.3201 (0.8); 4.3110 (0.7); 4.3006 (0.6); 4.2885 (0.7);
4.2780 (0.6); 4.2622 (0.8); 4.2514 (0.7); 4.2397 (0.8); 4.2291 (0.7); 4.1690 (0.9); 4.1452 (0.9); 4.1216
(0.3); 3.9374 (0.7); 3.9202 (0.8); 3.9133 (0.8); 3.9057 (0.5); 3.8962 (0.9); 3.8882 (0.9); 3.8668 (1.2);
3.8494 (1.2); 3.8435 (0.9); 3.8261 (0.8); 3.8184 (0.8); 3.8015 (0.6); 3.7945 (0.7); 3.7775 (0.6); 3.1384
(0.6); 2.0818 (4.4); 1.7188 (3.6); 1.4488 (0.8); 1.3192 (1.2); 1.2954 (2.6); 1.2716 (1.2); 1.1420 (2.4);
1.0728 (0.4); 1.0489 (0.5); 1.0251 (0.5); 0.1058 (7.2); 0.0462 (0.9); 0.0354 (32.5); 0.0245 (1.4)
I-229: ¹H-NMR(400.2 MHz, d₆-DMSO):
δ = 9.0213 (1.4); 9.0010 (1.4); 7.9521 (0.7); 7.7693 (6.5); 7.7265 (0.6); 7.7065 (1.7); 7.6875 (1.4);
7.6483 (4.3); 7.6284 (1.1); 7.5717 (1.4); 7.5526 (1.0); 7.2486 (2.6); 7.1010 (1.3); 7.0976 (1.2); 7.0806
(1.4); 7.0770 (1.4); 6.6504 (2.9); 6.6299 (2.7); 5.0833 (0.9); 5.0647 (1.2); 5.0464 (0.9); 4.4758 (2.2);
4.4543 (4.2); 4.4322 (2.5); 3.3304 (27.6); 3.0683 (0.4); 3.0509 (0.8); 3.0298 (1.4); 3.0204 (0.8);
3.0081 (0.7); 2.9983 (1.4); 2.9769 (0.8); 2.9594 (0.4); 2.8911 (5.0); 2.7325 (4.5); 2.6010 (16.0);
2.5247 (0.5); 2.5112 (10.1); 2.5070 (20.6); 2.5025 (27.3); 2.4980 (20.0); 2.4936 (10.0); 1.4115 (6.2);
1.3941 (6.2); 1.2404 (0.5)
I-230: ¹H-NMR(300.2 MHz, CDCl3):
δ = 7.9168 (5.5); 7.9080 (5.5); 7.6276 (0.6); 7.6013 (3.3); 7.5938 (2.9); 7.5827 (8.1); 7.5793 (7.5);
7.5685 (0.8); 7.5635 (0.7); 7.4799 (3.7); 7.4630 (0.6); 7.4482 (1.7); 7.4365 (2.3); 7.4297 (2.0); 7.4175
(1.6); 7.4095 (0.9); 7.3414 (3.6); 7.3148 (4.2); 7.2983 (24.6); 7.0391 (4.1); 6.9219 (2.2); 6.8954 (1.9);
6.6557 (1.0); 6.6365 (1.9); 6.6171 (1.0); 6.3145 (6.2); 6.3056 (6.0); 4.1691 (1.9); 4.1486 (1.9); 4.1207
(4.1); 4.1002 (3.9); 4.0723 (2.1); 4.0519 (2.0); 2.4787 (12.0); 2.4718 (6.7); 2.4503 (0.6); 2.3451 (0.4);
2.2732 (16.0); 2.0655 (0.6); 2.0490 (1.1); 2.0375 (1.3); 2.0211 (2.3); 2.0046 (1.3); 1.9932 (1.3);
1.9767 (0.6); 1.6070 (8.7); 1.2944 (1.1); 1.0778 (1.5); 1.0631 (3.6); 1.0549 (4.2); 1.0412 (2.5); 1.0347
(3.8); 1.0266 (3.6); 1.0134 (1.9); 0.9915 (0.4); 0.9639 (0.3); 0.9246 (0.4); 0.9076 (0.4); 0.8750 (2.1);
0.8613 (4.6); 0.8538 (4.2); 0.8452 (4.2); 0.8381 (4.6); 0.8220 (1.4); 0.1084 (2.4); 0.0493 (1.2); 0.0385
(26.0); 0.0276 (1.1)
I-231: ¹H-NMR(499.9 MHz, d₆-DMSO):
δ = 8.7846 (1.1); 8.7735 (1.9); 8.7623 (0.9); 8.0888 (5.9); 7.7555 (1.0); 7.7392 (2.4); 7.7234 (2.1);
7.6995 (3.1); 7.6856 (4.8); 7.6123 (2.0); 7.5959 (1.5); 7.0474 (2.7); 7.0321 (2.9); 6.9118 (3.7); 6.7791
(2.1); 6.7639 (1.8); 3.5016 (1.6); 3.4883 (3.1); 3.4750 (3.0); 3.4612 (1.2); 3.3319 (3.8); 2.8178 (2.6);
2.8033 (4.2); 2.7888 (2.1); 2.5046 (1.1); 2.2585 (16.0); 2.2399 (0.5); 2.2219 (0.4); 2.2159 (0.4);
2.1646 (14.6); −0.0002 (0.4)
I-232: ¹H-NMR(300.2 MHz, CDCl3):
δ = 8.2795 (12.7); 8.1473 (1.4); 8.1280 (0.8); 7.3788 (3.5); 7.3523 (4.0); 7.3015 (25.6); 7.2705 (5.2);
7.2437 (2.9); 7.0803 (3.8); 7.0117 (2.2); 6.9856 (1.8); 6.6921 (2.0); 6.6896 (2.2); 6.6851 (2.3); 6.6826
(2.2); 6.6653 (1.8); 6.6626 (1.9); 6.6583 (2.2); 6.6556 (2.0); 6.6170 (1.9); 6.6145 (1.9); 6.6095 (2.6);
6.5904 (1.4); 6.5876 (1.5); 6.5829 (2.8); 6.5804 (2.4); 6.5698 (3.7); 6.5628 (5.2); 6.5555 (2.2); 5.3413
(3.9); 4.2815 (2.0); 4.2615 (1.9); 4.2332 (4.2); 4.2132 (4.0); 4.1986 (0.4); 4.1848 (2.1); 4.1744 (0.7);
4.1649 (2.1); 4.1506 (0.5); 3.8640 (5.5); 2.5202 (6.4); 2.5135 (11.7); 2.5061 (6.4); 2.3439 (16.0);
2.2704 (0.5); 2.0875 (2.1); 1.5984 (12.0); 1.3478 (0.5); 1.3244 (1.2); 1.3007 (3.1); 1.2769 (0.8);
0.9440 (0.8); 0.9224 (2.4); 0.8992 (0.9); 0.1104 (1.3); 0.0512 (0.9); 0.0404 (26.0); 0.0295 (0.9)
I-233: ¹H-NMR(499.9 MHz, d₆-DMSO):
δ = 9.0602 (1.1); 9.0487 (2.1); 9.0370 (1.2); 7.8022 (6.2); 7.7844 (1.2); 7.7691 (2.1); 7.7535 (2.2);
7.7311 (4.6); 7.5479 (1.3); 7.5321 (3.2); 7.5159 (4.1); 7.5133 (4.1); 7.5002 (4.8); 7.4835 (1.8); 6.0570
(0.7); 6.0484 (1.0); 6.0457 (1.0); 6.0370 (0.8); 5.9646 (0.7); 5.9561 (1.0); 5.9532 (1.0); 5.9446 (0.8);
3.9395 (0.4); 3.9235 (0.6); 3.9105 (1.0); 3.8966 (0.8); 3.8796 (1.0); 3.8716 (1.1); 3.8666 (1.3); 3.8542
(0.9); 3.8440 (0.6); 3.8357 (0.8); 3.8258 (0.9); 3.8170 (0.6); 3.8076 (0.4); 3.7975 (0.4); 3.3441 (3.6);
2.6060 (16.0); 2.5683 (0.4); 2.5057 (0.8)
I-234: ¹H-NMR(400.1 MHz, d₆-DMSO):
δ = 9.2779 (0.8); 9.2627 (1.8); 9.2473 (0.9); 7.9612 (2.4); 7.6866 (0.8); 7.6669 (2.1); 7.6472 (1.7);
7.6128 (2.2); 7.5931 (1.2); 7.4750 (2.9); 7.4560 (1.8); 7.4359 (1.4); 7.2934 (2.4); 7.2734 (2.7); 7.0648
(3.0); 6.8913 (1.6); 6.8714 (1.5); 6.4239 (0.9); 6.4103 (1.8); 6.3967 (1.0); 4.9665 (1.3); 4.9533 (3.1);
4.9402 (1.4); 4.1108 (0.7); 4.0956 (0.8); 4.0729 (1.6); 4.0575 (1.6); 4.0347 (0.9); 4.0193 (0.8); 3.5863
(1.0); 3.5726 (3.1); 3.5591 (3.4); 3.5456 (1.4); 3.3121 (63.4); 3.2970 (2.4); 3.2828 (3.8); 3.2689 (3.4);
3.2552 (1.4); 2.8991 (16.0); 2.7402 (14.1); 2.5135 (11.0); 2.5091 (15.1); 2.5047 (11.4); 2.4005 (7.8);
2.2240 (10.8)
I-235: ¹H-NMR(400.1 MHz, d₆-DMSO):
δ = 9.0150 (3.2); 8.7090 (6.5); 8.7037 (6.6); 7.9720 (3.7); 7.9660 (3.7); 7.9509 (4.4); 7.9449 (4.4);
7.7240 (16.0); 7.7164 (8.1); 7.6950 (6.3); 7.6284 (2.2); 7.6088 (5.3); 7.5890 (3.5); 7.4936 (4.5);
7.4744 (3.4); 7.3944 (6.4); 7.3560 (3.6); 7.3359 (3.1); 7.2243 (3.1); 7.0849 (6.7); 6.9456 (3.3); 4.2523
(1.8); 4.2195 (3.6); 4.1841 (1.9); 3.3121 (26.6); 2.8986 (0.4); 2.7395 (0.4); 2.5962 (39.8); 2.5130
(13.2); 2.5087 (17.5); 2.5045 (13.1)
I-236: ¹H-NMR(400.0 MHz, d₆-DMSO):
δ = 9.2383 (1.5); 9.2182 (1.5); 7.9532 (0.5); 7.8164 (7.9); 7.7483 (2.1); 7.7356 (0.9); 7.7269 (2.6);
7.7161 (2.0); 7.6954 (4.0); 7.6698 (2.1); 7.6503 (1.0); 7.6261 (2.8); 7.6007 (1.5); 7.5713 (2.1); 7.5501
(2.2); 7.5248 (1.6); 7.5209 (1.8); 7.5036 (1.4); 7.4995 (1.5); 7.2886 (1.6); 7.2852 (1.7); 7.2677 (1.4);
7.2641 (1.5); 5.3080 (0.8); 5.2897 (1.2); 5.2712 (0.8); 3.3698 (36.6); 3.3631 (56.7); 3.3598 (62.3);
2.8901 (2.9); 2.7320 (2.6); 2.6126 (16.0); 2.5268 (0.4); 2.5132 (9.2); 2.5089 (19.5); 2.5044 (26.4);
2.4999 (19.4); 2.4955 (9.6); 2.4401 (11.2); 2.3700 (0.3); 1.5339 (6.0); 1.5165 (5.9); 1.2382
(0.3); −0.0002 (0.4)
I-237: ¹H-NMR(300.2 MHz, CDCl3):
δ = 8.3491 (9.8); 8.0537 (9.4); 7.6696 (0.4); 7.6406 (3.7); 7.6346 (3.0); 7.6259 (7.2); 7.6229 (7.6);
7.6088 (0.6); 7.5308 (3.7); 7.5101 (0.5); 7.4968 (1.6); 7.4831 (2.1); 7.4765 (2.0); 7.4664 (1.6); 7.4584
(1.0); 7.3238 (3.5); 7.2981 (19.6); 7.0734 (4.1); 6.9790 (2.2); 6.9529 (1.9); 6.6691 (1.0); 6.6486 (1.9);
6.6285 (1.0); 4.1443 (1.9); 4.1235 (1.9); 4.1170 (2.4); 4.0953 (3.9); 4.0746 (3.7); 4.0463 (2.0); 4.0255
(1.9); 2.5184 (0.7); 2.4618 (12.0); 2.4548 (6.6); 2.3965 (0.3); 2.3248 (16.0); 2.0405 (1.9); 1.6050
(9.0); 1.2945 (0.7); 0.1086 (1.6); 0.0488 (0.8); 0.0382 (16.8); 0.0272 (0.5)
I-238: ¹H-NMR(300.2 MHz, CDCl3):
δ = 7.5570 (1.8); 7.5516 (1.4); 7.5425 (3.0); 7.5396 (3.3); 7.4550 (1.6); 7.4110 (0.7); 7.4021 (0.7);
7.3972 (1.0); 7.3881 (2.0); 7.3724 (0.5); 7.3613 (1.8); 7.2986 (3.6); 7.0724 (1.8); 6.9900 (1.0); 6.9633
(0.8); 6.5969 (0.4); 6.5777 (0.8); 6.5576 (0.4); 4.2838 (0.8); 4.2634 (0.8); 4.2347 (1.7); 4.2142 (1.6);
4.1855 (0.9); 4.1650 (0.8); 2.5778 (16.0); 2.5043 (5.2); 2.3137 (7.0); 1.6055 (0.6); 1.2948 (0.5);
0.0388 (4.0)
I-239: ¹H-NMR(400.0 MHz, d₆-DMSO):
δ = 9.0252 (2.4); 9.0110 (4.1); 8.9982 (2.7); 8.9680 (0.4); 8.3158 (0.5); 8.0864 (16.0); 8.0805 (7.2);
7.7596 (1.7); 7.7419 (4.6); 7.7221 (5.0); 7.7027 (6.8); 7.6814 (9.3); 7.5988 (4.3); 7.5810 (3.6); 7.4555
(6.5); 7.4358 (11.0); 7.3784 (11.2); 7.3735 (8.9); 7.3577 (7.7); 7.2511 (0.5); 7.1957 (0.3); 5.8053
(1.4); 5.7880 (2.2); 5.7793 (1.8); 5.7555 (1.4); 5.6703 (2.2); 3.8729 (0.7); 3.8531 (1.6); 3.8366 (2.5);
3.8230 (3.0); 3.8030 (2.9); 3.7977 (2.7); 3.7870 (2.6); 3.7713 (1.9); 3.7624 (2.1); 3.7474 (1.9); 3.7177
(0.8); 3.3210 (174.5); 3.3165 (103.2); 2.8312 (0.4); 2.6704 (2.0); 2.5056 (268.7); 2.5012 (366.7);
2.4967 (331.7); 2.4058 (0.5); 2.3284 (2.1); 1.2504 (0.4); 1.2284 (0.6); 0.1461 (0.9); 0.0075
(24.0); −0.0004 (231.4); −0.0061 (97.0); −0.0696 (0.4); −0.0772 (0.3); −0.1495 (1.0); −0.1552 (0.6)
I-240: ¹H-NMR(300.2 MHz, CDCl3):
δ = 8.3174 (14.7); 7.9784 (1.1); 7.9600 (1.8); 7.9422 (1.1); 7.6761 (6.4); 7.6586 (8.7); 7.6341 (0.3);
7.5361 (4.3); 7.4908 (0.5); 7.4782 (1.8); 7.4701 (1.9); 7.4626 (2.5); 7.4561 (2.2); 7.4477 (1.6); 7.4396
(1.2); 7.3622 (4.6); 7.3351 (5.1); 7.2982 (22.5); 6.9473 (5.2); 6.8639 (2.8); 6.8374 (2.5); 5.3376 (2.3);
4.2966 (2.3); 4.2769 (2.3); 4.2483 (4.9); 4.2285 (4.7); 4.1999 (2.5); 4.1802 (2.4); 2.5065 (14.8);
2.4994 (8.3); 1.9042 (0.6); 1.8873 (1.2); 1.8759 (1.4); 1.8593 (2.5); 1.8429 (1.4); 1.8315 (1.4); 1.8147
(0.7); 1.5911 (16.0); 1.2933 (0.6); 1.0485 (1.7); 1.0332 (4.6); 1.0264 (5.0); 1.0113 (2.7); 1.0049 (4.8);
0.9985 (4.4); 0.9835 (2.0); 0.7248 (2.1); 0.7095 (5.8); 0.7038 (5.0); 0.6931 (4.6); 0.6873 (5.9); 0.6710
(1.6); 0.1079 (5.2); 0.0483 (0.9); 0.0375 (22.6); 0.0266 (0.9)
I-241: ¹H-NMR(400.1 MHz, d₆-DMSO):
δ = 9.3033 (0.9); 9.2884 (2.0); 9.2735 (1.0); 7.9613 (2.4); 7.6786 (0.8); 7.6589 (2.3); 7.6391 (1.9);
7.6043 (2.4); 7.5846 (1.4); 7.4729 (3.1); 7.4517 (1.9); 7.4308 (1.5); 7.2951 (2.5); 7.2751 (2.8); 7.0644
(3.2); 6.8888 (1.7); 6.8696 (1.6); 6.2544 (1.8); 6.2301 (2.0); 4.0843 (0.8); 4.0694 (0.8); 4.0453 (1.7);
4.0304 (1.6); 4.0062 (1.0); 3.9911 (0.9); 3.5998 (0.8); 3.5847 (0.6); 3.5751 (0.8); 3.5493 (0.3); 3.3116
(71.7); 2.8993 (16.0); 2.7403 (14.3); 2.5136 (12.0); 2.5093 (16.8); 2.5049 (12.9); 2.4028 (8.2); 2.2232
(11.6); 1.8908 (1.5); 1.8630 (1.7); 1.7219 (1.4); 1.6897 (1.7); 1.5808 (0.8); 1.5521 (0.9); 1.4834 (0.5);
1.4586 (1.4); 1.4277 (1.5); 1.4028 (0.7); 1.2662 (0.5); 1.2355 (1.3); 1.2043 (1.4); 1.1735 (0.7); 1.1457
(0.6); 1.1152 (0.8); 1.0850 (0.6)
I-242: ¹H-NMR(400.1 MHz, d₆-DMSO):
δ = 8.9961 (0.8); 8.9817 (1.6); 8.9668 (0.9); 7.7402 (6.3); 7.6413 (3.7); 7.6206 (2.3); 7.6009 (1.5);
7.5671 (2.5); 7.5461 (3.2); 7.4991 (1.8); 7.4797 (1.5); 7.4333 (2.6); 7.4007 (3.0); 7.3964 (3.3); 7.3799
(2.7); 7.3752 (2.8); 7.2291 (1.3); 7.0898 (2.7); 6.9505 (1.3); 6.0595 (0.5); 6.0472 (1.0); 6.0341 (0.6);
5.9439 (0.5); 5.9318 (0.9); 5.9185 (0.6); 3.8907 (0.6); 3.8851 (0.7); 3.8751 (1.4); 3.8599 (1.0); 3.8353
(0.7); 3.8203 (1.2); 3.8054 (0.8); 3.3123 (14.2); 2.8988 (1.0); 2.7400 (0.9); 2.6032 (16.0); 2.5132
(6.0); 2.5089 (8.1); 2.5047 (6.2)
I-243: ¹H-NMR(400.0 MHz, d₆-DMSO):
δ = 8.3132 (0.8); 8.2568 (3.7); 8.0288 (0.3); 7.7602 (0.8); 7.7415 (2.4); 7.7224 (2.2); 7.6915 (2.9);
7.6729 (4.9); 7.6093 (2.0); 7.5885 (1.6); 7.5273 (1.6); 7.5245 (1.7); 7.5048 (2.3); 7.4026 (3.4); 7.3834
(2.6); 5.7884 (0.5); 4.5936 (0.6); 4.5802 (0.4); 4.3080 (2.2); 4.2916 (3.7); 4.2749 (2.4); 3.4622 (0.5);
3.4501 (0.5); 3.4348 (0.6); 3.3397 (515.8); 3.3363 (593.5); 3.3304 (1011.5); 3.2501 (0.4); 3.1413
(2.0); 3.1254 (3.3); 3.1084 (2.0); 2.6755 (2.8); 2.6710 (3.8); 2.6665 (2.8); 2.5413 (33.3); 2.5243 (9.1);
2.5108 (239.2); 2.5065 (498.4); 2.5020 (665.5); 2.4975 (483.1); 2.4931 (238.8); 2.4451 (16.0);
2.4186 (0.5); 2.4109 (0.5); 2.3332 (2.8); 2.3287 (3.9); 2.3241 (2.9); 2.2922 (0.4); 2.1739 (0.5); 1.2978
(0.4); 1.2585 (0.5); 1.2350 (0.8); −0.0002 (7.7)
I-244: ¹H-NMR(400.0 MHz, d₆-DMSO):
δ = 9.1630 (1.3); 9.1435 (1.3); 7.9542 (0.5); 7.7907 (6.0); 7.7297 (0.5); 7.7092 (1.6); 7.6903 (1.3);
7.6509 (1.9); 7.6327 (3.5); 7.5707 (1.3); 7.5490 (1.2); 7.4909 (0.4); 7.4847 (3.9); 7.4803 (1.5); 7.4683
(1.6); 7.4636 (5.7); 7.4578 (0.9); 7.3689 (4.9); 7.3477 (3.5); 5.1174 (0.8); 5.0991 (1.2); 5.0809 (0.9);
3.3898 (53.5); 2.8928 (3.2); 2.7345 (2.8); 2.6099 (16.0); 2.5169 (5.0); 2.5125 (10.5); 2.5080 (14.1);
2.5035 (10.2); 2.4991 (4.9); 1.4317 (6.2); 1.4142 (6.2)
I-245: ¹H-NMR(400.2 MHz, d₆-DMSO):
δ = 9.0478 (2.0); 9.0267 (2.0); 8.1857 (11.7); 7.7487 (0.7); 7.7288 (2.2); 7.7195 (0.4); 7.7086 (2.3);
7.6824 (4.9); 7.6779 (4.1); 7.6337 (1.9); 7.6139 (1.3); 7.2161 (2.8); 7.1965 (3.1); 6.9174 (3.6); 6.8959
(2.0); 6.8761 (1.7); 5.7556 (3.6); 5.1515 (0.4); 5.1378 (0.9); 5.1195 (1.1); 5.1018 (0.5); 3.3219 (58.5);
2.7245 (0.8); 2.7068 (2.0); 2.6912 (2.0); 2.6750 (1.3); 2.6705 (1.0); 2.6658 (0.7); 2.5238 (2.2); 2.5189
(3.4); 2.5104 (42.8); 2.5060 (86.2); 2.5014 (112.5); 2.4968 (80.8); 2.4923 (39.0); 2.3328 (0.5); 2.3282
(0.7); 2.3237 (0.5); 2.2177 (16.0); 2.0181 (0.4); 2.0050 (0.6); 1.9938 (0.6); 1.9827 (0.8); 1.9737 (1.0);
1.9602 (0.6); 1.8824 (0.5); 1.8702 (0.7); 1.8573 (0.7); 1.8375 (0.7); 1.8033 (0.4); 1.7813 (0.9); 1.7770
(0.8); 1.7622 (1.4); 1.7514 (1.7); 1.7391 (1.3); −0.0003 (4.6)
I-246: ¹H-NMR(400.2 MHz, d₆-DMSO):
δ = 8.7461 (0.7); 8.7321 (1.3); 8.7178 (0.7); 7.7602 (6.1); 7.7165 (0.6); 7.6970 (1.8); 7.6772 (1.6);
7.6545 (2.1); 7.6349 (1.0); 7.5779 (2.5); 7.5222 (1.4); 7.5023 (1.1); 7.1991 (0.6); 7.1912 (0.8); 7.1847
(0.8); 7.1766 (1.3); 7.1687 (0.8); 7.1620 (0.7); 7.1541 (0.7); 7.1470 (0.6); 7.1354 (0.6); 7.1241 (1.3);
7.1125 (1.3); 7.1010 (0.9); 7.0895 (0.8); 7.0358 (0.4); 7.0266 (0.7); 7.0160 (0.8); 7.0059 (1.1); 6.9972
(0.6); 6.9843 (0.5); 3.5856 (1.0); 3.5690 (2.6); 3.5536 (2.7); 3.5371 (1.0); 3.3292 (41.8); 2.8885 (1.6);
2.8717 (3.1); 2.8549 (1.5); 2.6761 (0.4); 2.6715 (0.6); 2.6673 (0.4); 2.5904 (16.0); 2.5070 (73.4);
2.5027 (91.6); 2.4982 (67.1); 2.3339 (0.4); 2.3294 (0.5); 2.3250 (0.4); −0.0002 (0.3)
I-247: ¹H-NMR(300.2 MHz, CDCl3):
δ = 8.2795 (16.0); 8.1331 (2.0); 8.1133 (1.2); 7.5136 (5.8); 7.4847 (11.4); 7.4247 (11.8); 7.4004 (9.4);
7.3742 (4.1); 7.3059 (25.6); 7.1014 (3.8); 7.0753 (3.3); 7.0128 (2.6); 7.0072 (3.2); 6.9862 (2.2);
6.9802 (2.9); 6.9416 (4.4); 6.9354 (5.9); 6.9286 (3.3); 5.3450 (5.8); 4.2593 (2.8); 4.2390 (2.7); 4.2123
(5.9); 4.1921 (5.8); 4.1653 (3.0); 4.1450 (2.9); 2.0307 (0.7); 2.0139 (1.4); 2.0025 (1.6); 1.9860 (3.0);
1.9694 (1.7); 1.9581 (1.6); 1.9415 (0.8); 1.5992 (8.5); 1.3536 (0.3); 1.3122 (0.5); 1.2991 (0.6); 1.0981
(1.8); 1.0821 (4.9); 1.0759 (5.3); 1.0608 (2.8); 1.0540 (5.3); 1.0475 (4.9); 1.0329 (2.3); 0.8064 (2.2);
0.7907 (6.5); 0.7849 (5.7); 0.7747 (5.2); 0.7685 (6.7); 0.7524 (1.8); 0.1149 (0.9); 0.0557 (0.9); 0.0450
(25.4); 0.0342 (1.0)
I-248: ¹H-NMR(300.2 MHz, CDCl3):
δ = 8.1266 (5.0); 7.9036 (0.4); 7.8855 (0.6); 7.8679 (0.4); 7.6500 (0.6); 7.6278 (1.4); 7.6047 (1.7);
7.5821 (0.8); 7.5260 (2.2); 7.4970 (3.7); 7.4243 (4.1); 7.3966 (2.8); 7.3734 (0.5); 7.2984 (6.6); 5.3364
(6.6); 4.2825 (1.0); 4.2620 (1.0); 4.2360 (2.2); 4.2155 (2.1); 4.1895 (1.1); 4.1690 (1.1); 2.7653 (16.0);
1.6067 (6.0); 1.2269 (0.5); 0.0362 (6.4)
I-249: ¹H-NMR(300.2 MHz, CDCl3):
δ = 8.3968 (0.5); 8.3882 (0.5); 8.0680 (0.6); 8.0595 (0.6); 7.9858 (10.8); 7.9770 (11.0); 7.8213 (11.1);
7.8157 (11.1); 7.7976 (0.9); 7.7924 (0.7); 7.6769 (0.6); 7.6732 (0.6); 7.6611 (0.4); 7.6364 (0.8);
7.6077 (10.2); 7.6026 (7.1); 7.5903 (16.0); 7.5795 (2.1); 7.5764 (1.9); 7.5660 (0.6); 7.5143 (0.4);
7.4855 (1.0); 7.4631 (10.2); 7.4337 (21.1); 7.4033 (1.4); 7.3900 (3.3); 7.3809 (3.1); 7.3756 (5.0);
7.3694 (4.1); 7.3582 (4.1); 7.3466 (15.7); 7.3180 (9.2); 7.2984 (15.9); 7.0106 (2.2); 6.9898 (4.2);
6.9691 (2.2); 6.6232 (7.6); 6.6169 (9.2); 6.6146 (8.7); 6.6083 (7.2); 6.5789 (0.4); 6.5727 (0.5); 6.5642
(0.4); 6.5135 (0.3); 6.5076 (0.4); 4.1012 (3.8); 4.0801 (3.8); 4.0542 (8.2); 4.0331 (8.0); 4.0072 (4.2);
3.9862 (4.3); 3.9673 (0.5); 2.0358 (1.3); 1.6858 (4.4); 1.2953 (0.9); 0.0484 (0.6); 0.0378 (14.6);
0.0269 (0.6)
I-250: ¹H-NMR(300.2 MHz, CDCl3):
δ = 8.7990 (2.2); 8.6869 (1.6); 8.6705 (1.7); 7.6472 (0.7); 7.6262 (2.2); 7.5848 (1.0); 7.5488 (0.5);
7.5400 (0.8); 7.5327 (0.5); 7.5185 (0.4); 7.2985 (22.1); 7.2730 (1.4); 7.2713 (1.3); 7.2548 (2.1);
7.2275 (1.1); 7.0412 (1.1); 6.9758 (0.6); 6.9475 (0.6); 6.4376 (0.4); 2.3905 (1.7); 2.3837 (3.2); 2.3763
(1.8); 2.3233 (4.3); 1.5876 (16.0); 1.2929 (1.4); 0.9195 (0.4); 0.1070 (1.0); 0.0482 (0.6); 0.0466 (0.4);
0.0450 (0.4); 0.0375 (20.8); 0.0266 (0.8)
I-251: ¹H-NMR(400.1 MHz, d₆-DMSO):
δ = 9.0184 (1.2); 9.0029 (2.4); 8.9874 (1.2); 8.7096 (3.9); 8.7043 (3.9); 7.9674 (2.8); 7.9615 (4.7);
7.9466 (2.8); 7.9407 (2.7); 7.7137 (4.3); 7.6926 (3.7); 7.6538 (9.7); 7.6180 (1.3); 7.5983 (3.2); 7.5786
(2.1); 7.4852 (2.7); 7.4662 (2.0); 7.3789 (3.8); 7.3379 (2.2); 7.3176 (1.9); 7.2192 (1.8); 7.0799 (3.9);
6.9406 (1.9); 4.2564 (1.2); 4.2408 (1.2); 4.2208 (2.7); 4.2051 (2.6); 4.1851 (1.4); 4.1694 (1.3); 3.3118
(25.4); 2.8986 (16.0); 2.7397 (14.5); 2.5130 (10.2); 2.5087 (13.5); 2.5045 (10.2); 2.3269 (0.5); 2.3146
(1.0); 2.3062 (1.2); 2.2941 (2.0); 2.2819 (1.2); 2.2737 (1.1); 2.2614 (0.5); 1.0942 (0.9); 1.0825 (2.4);
1.0762 (3.7); 1.0679 (2.4); 1.0619 (2.4); 1.0558 (3.3); 1.0477 (1.6); 1.0313 (0.6); 1.0076 (1.7); 0.9991
(3.7); 0.9940 (3.7); 0.9875 (4.1); 0.9814 (3.1); 0.9695 (0.9)
I-252: ¹H-NMR(300.2 MHz, CDCl3):
δ = 8.4702 (16.0); 8.4341 (6.5); 8.1276 (1.0); 8.1101 (1.6); 8.0918 (1.0); 7.7621 (4.2); 7.7575 (7.0);
7.7528 (4.1); 7.7179 (3.4); 7.7097 (2.9); 7.7054 (3.1); 7.6990 (8.9); 7.6957 (8.4); 7.6844 (0.8); 7.6800
(0.8); 7.6646 (0.4); 7.5728 (3.9); 7.5382 (0.6); 7.5315 (0.5); 7.5231 (1.7); 7.5118 (2.5); 7.5048 (2.4);
7.4922 (2.0); 7.4782 (4.7); 7.4500 (10.6); 7.4327 (0.8); 7.4258 (0.7); 7.3647 (0.5); 7.3576 (0.3);
7.3282 (0.4); 7.2987 (28.4); 7.2877 (3.9); 7.2805 (3.4); 7.2597 (2.7); 7.2529 (2.6); 6.1710 (1.0);
6.1604 (1.1); 6.1469 (1.2); 6.1365 (1.1); 6.0155 (1.0); 6.0050 (1.1); 5.9915 (1.2); 5.9813 (1.1); 4.4022
(0.6); 4.3916 (0.6); 4.3797 (0.7); 4.3689 (0.6); 4.3534 (0.7); 4.3427 (0.8); 4.3309 (0.7); 4.3203 (0.8);
4.3113 (0.7); 4.3004 (0.6); 4.2886 (0.7); 4.2781 (0.6); 4.2623 (0.8); 4.2517 (0.8); 4.2399 (0.8); 4.2293
(0.7); 4.1923 (0.4); 4.1686 (1.2); 4.1447 (1.2); 4.1210 (0.4); 3.9396 (0.7); 3.9225 (0.8); 3.9156 (0.8);
3.8984 (0.8); 3.8908 (0.7); 3.8695 (1.1); 3.8523 (1.1); 3.8287 (0.8); 3.8211 (0.8); 3.8040 (0.6); 3.7969
(0.7); 3.7801 (0.6); 2.0813 (5.7); 2.0472 (1.9); 1.6503 (13.6); 1.3188 (1.7); 1.2949 (3.4); 1.2711 (1.5);
1.1421 (0.7); 1.0522 (0.4); 0.1057 (5.8); 0.0458 (1.0); 0.0350 (25.8); 0.0241 (0.8)
I-253: ¹H-NMR(300.2 MHz, CDCl3):
δ = 8.3098 (14.5); 7.9547 (1.5); 7.9304 (1.5); 7.7026 (0.3); 7.6747 (5.8); 7.6573 (9.6); 7.6455 (5.2);
7.6227 (3.1); 7.5953 (6.6); 7.5546 (6.4); 7.5321 (2.1); 7.5034 (1.4); 7.4972 (1.9); 7.4881 (1.7); 7.4825
(2.6); 7.4759 (2.1); 7.4666 (1.6); 7.4582 (1.1); 7.3048 (11.2); 5.4822 (0.5); 5.4588 (2.0); 5.4351 (3.0);
5.4114 (2.0); 5.3881 (0.5); 4.1741 (1.0); 4.1503 (1.0); 4.1265 (0.3); 2.0871 (4.3); 1.7042 (16.0);
1.6809 (16.0); 1.6197 (1.2); 1.3256 (1.3); 1.3018 (2.8); 1.2780 (1.2); 0.9634 (0.4); 0.9389 (0.3);
0.0537 (0.3); 0.0429 (10.5); 0.0320 (0.5)
I-254: ¹H-NMR(300.2 MHz, CDCl3):
δ = 7.6122 (0.5); 7.5860 (3.5); 7.5788 (3.0); 7.5743 (3.1); 7.5675 (8.5); 7.5643 (8.9); 7.5481 (5.7);
7.5193 (8.5); 7.4594 (4.2); 7.4330 (8.1); 7.4039 (6.4); 7.3933 (2.6); 7.3808 (1.8); 7.3725 (1.1); 7.2987
(20.4); 6.4557 (1.0); 6.4350 (2.0); 6.4141 (1.1); 4.2668 (2.2); 4.2457 (2.1); 4.2189 (4.8); 4.1977 (4.5);
4.1709 (2.4); 4.1497 (2.3); 2.7423 (1.9); 2.7172 (6.4); 2.6921 (6.6); 2.6672 (2.0); 1.5946 (14.3);
1.3015 (7.2); 1.2766 (16.0); 1.2514 (6.6); 0.1076 (1.1); 0.0482 (0.7); 0.0374 (20.6); 0.0266 (0.7)
I-255: ¹H-NMR(300.2 MHz, CDCl3):
δ = 8.0844 (10.0); 8.0427 (0.6); 8.0239 (1.0); 8.0078 (0.6); 7.6778 (0.5); 7.6507 (2.1); 7.6294 (5.9);
7.6123 (0.5); 7.5837 (3.5); 7.5192 (2.6); 7.4600 (1.0); 7.4513 (1.9); 7.4442 (1.3); 7.4371 (0.8); 7.4291
(1.3); 7.4231 (1.3); 7.3955 (4.3); 7.3896 (5.6); 7.3863 (6.3); 7.3584 (0.7); 7.3077 (0.6); 7.2986 (34.0);
6.1275 (0.8); 6.1168 (0.8); 6.1041 (0.9); 6.0934 (0.8); 5.9724 (0.8); 5.9614 (0.9); 5.9486 (0.9); 5.9378
(0.8); 5.3378 (7.1); 4.3544 (0.4); 4.3435 (0.4); 4.3323 (0.4); 4.3212 (0.4); 4.3059 (0.5); 4.2949 (0.5);
4.2837 (0.5); 4.2727 (0.5); 4.2646 (0.5); 4.2541 (0.4); 4.2424 (0.4); 4.2313 (0.4); 4.2159 (0.6); 4.2051
(0.5); 4.1935 (0.6); 4.1828 (0.5); 3.9033 (0.5); 3.8862 (0.6); 3.8795 (0.6); 3.8622 (0.6); 3.8544 (0.5);
3.8374 (0.6); 3.8320 (0.9); 3.8146 (0.9); 3.8092 (0.6); 3.7915 (0.5); 3.7837 (0.5); 3.7664 (0.4); 3.7602
(0.5); 3.7430 (0.4); 2.2941 (0.4); 2.2757 (0.8); 2.2682 (0.9); 2.2599 (0.6); 2.2504 (1.9); 2.2394 (0.7);
2.2319 (0.8); 2.2245 (1.0); 2.2063 (0.5); 2.0450 (16.0); 1.5807 (13.6); 1.2932 (0.5); 1.2092 (1.4);
1.2004 (4.2); 1.1916 (4.6); 1.1868 (6.4); 1.1844 (6.1); 1.1787 (3.6); 1.1664 (2.4); 1.1606 (3.9); 1.1518
(1.8); 1.1295 (0.4); 0.0488 (1.3); 0.0456 (0.8); 0.0380 (37.0); 0.0271 (1.2)
I-256: ¹H-NMR(400.1 MHz, d₆-DMSO):
δ = 9.2177 (0.4); 9.2023 (0.8); 9.1869 (0.4); 7.9612 (0.9); 7.7155 (0.4); 7.6959 (0.9); 7.6762 (0.8);
7.6467 (1.0); 7.6273 (0.5); 7.4976 (1.3); 7.4859 (0.8); 7.4655 (0.6); 7.3032 (1.1); 7.2832 (1.2); 7.0750
(1.4); 6.9091 (0.7); 6.8892 (0.7); 4.1555 (0.3); 4.1402 (0.4); 4.1178 (0.8); 4.1024 (0.8); 4.0797 (0.4);
4.0644 (0.4); 3.3187 (10.2); 2.9032 (16.0); 2.7399 (5.3); 2.5134 (4.6); 2.5090 (6.4); 2.5047 (4.8);
2.4134 (3.6); 2.2299 (4.9)
I-257: ¹H-NMR(300.2 MHz, CDCl3):
δ = 7.5453 (1.2); 7.5247 (3.5); 7.5036 (0.3); 7.4232 (1.6); 7.3867 (0.7); 7.3775 (1.4); 7.3706 (2.2);
7.3559 (0.9); 7.3444 (1.9); 7.2985 (10.6); 7.0696 (1.8); 6.9993 (1.5); 6.9741 (1.4); 4.2381 (0.8);
4.2176 (0.8); 4.1880 (1.6); 4.1676 (1.5); 4.1379 (0.8); 4.1175 (0.8); 3.7533 (0.4); 3.7386 (16.0);
3.5733 (0.8); 3.5506 (1.7); 3.5329 (1.8); 3.5103 (0.8); 2.5142 (2.0); 2.4980 (5.6); 2.4911 (6.4); 2.4681
(2.0); 2.3286 (6.9); 2.0838 (0.5); 2.0608 (1.7); 2.0430 (4.7); 2.0380 (2.6); 2.0148 (1.5); 1.9916 (0.4);
1.5954 (4.2); 0.0487 (0.5); 0.0379 (11.1); 0.0270 (0.4)
I-258: ¹H-NMR(400.1 MHz, d₆-DMSO):
δ = 8.9907 (1.8); 8.9761 (3.7); 8.9613 (2.0); 8.7028 (0.4); 7.9613 (2.6); 7.7598 (7.2); 7.6621 (2.0);
7.6484 (15.2); 7.6311 (2.6); 7.6112 (5.2); 7.5914 (3.5); 7.5344 (2.1); 7.5302 (2.0); 7.5134 (5.8);
7.5092 (6.2); 7.4917 (13.6); 7.4710 (6.8); 7.4220 (5.9); 7.3808 (3.4); 7.3606 (3.3); 7.3114 (2.3);
7.2250 (2.9); 7.0857 (6.2); 6.9465 (3.0); 6.0414 (1.2); 6.0293 (2.4); 6.0162 (1.3); 5.9263 (1.2); 5.9138
(2.3); 5.9007 (1.3); 3.8786 (1.9); 3.8657 (3.6); 3.8515 (2.4); 3.8194 (1.8); 3.8085 (3.4); 3.7942 (2.2);
3.5581 (0.7); 3.5435 (0.7); 3.3115 (36.9); 2.9596 (0.5); 2.9429 (1.0); 2.9256 (0.5); 2.8989 (16.0);
2.7401 (14.6); 2.5132 (17.7); 2.5090 (23.8); 2.5048 (18.7); 2.3305 (0.8); 2.3181 (1.6); 2.3098 (1.9);
2.2976 (3.2); 2.2902 (1.8); 2.2856 (2.2); 2.2774 (2.0); 2.2649 (1.0); 1.1053 (1.4); 1.0938 (4.0); 1.0874
(6.0); 1.0787 (4.1); 1.0733 (4.3); 1.0670 (5.6); 1.0588 (2.9); 1.0428 (1.0); 1.0232 (0.8); 1.0129 (2.5);
1.0044 (5.7); 0.9991 (6.3); 0.9929 (7.0); 0.9868 (5.9); 0.9750 (2.0)
I-259: ¹H-NMR(300.2 MHz, CDCl3):
δ = 8.2674 (10.5); 8.0861 (1.1); 7.5634 (5.6); 7.5353 (7.5); 7.5116 (7.1); 7.4188 (2.1); 7.3941 (2.9);
7.3879 (0.8); 7.3693 (1.0); 7.3656 (0.6); 7.2985 (20.5); 7.2754 (2.2); 7.2687 (2.1); 7.2475 (5.8);
7.2435 (6.8); 7.2310 (0.6); 7.2184 (4.2); 7.2062 (0.4); 4.4886 (1.8); 4.4681 (1.8); 4.4409 (3.9); 4.4204
(3.8); 4.3930 (2.0); 4.3726 (1.9); 2.0831 (0.7); 1.5829 (16.0); 1.2975 (0.8); 0.1081 (0.8); 0.0492 (0.8);
0.0384 (20.6); 0.0274 (0.6)
I-260: ¹H-NMR(300.2 MHz, CDCl3):
δ = 8.3093 (5.2); 7.8234 (0.5); 7.8038 (0.3); 7.6838 (0.4); 7.6631 (0.8); 7.6358 (0.9); 7.6071 (1.0);
7.5840 (0.6); 7.4487 (0.7); 7.4218 (1.0); 7.3847 (1.5); 7.3581 (1.6); 7.3019 (16.6); 7.0752 (1.6);
6.9976 (0.9); 6.9701 (0.8); 5.3415 (7.3); 4.3152 (0.8); 4.2952 (0.8); 4.2675 (1.7); 4.2475 (1.7); 4.2198
(0.9); 4.1998 (0.8); 3.5416 (0.9); 3.5235 (0.9); 2.5230 (2.6); 2.5160 (4.8); 2.5087 (2.7); 2.3078 (6.6);
2.0496 (16.0); 1.5957 (11.0); 0.1100 (0.5); 0.0510 (0.5); 0.0403 (15.4); 0.0293 (0.6)
I-261: ¹H-NMR(400.1 MHz, CDCl3):
δ = 8.2789 (7.1); 7.8560 (1.0); 7.8380 (1.0); 7.6278 (0.3); 7.6072 (4.0); 7.5945 (5.5); 7.4708 (3.1);
7.4495 (1.3); 7.4390 (1.8); 7.4343 (1.5); 7.4274 (1.2); 7.4213 (0.8); 7.2585 (11.1); 7.2378 (5.8);
7.1706 (5.2); 7.1510 (3.4); 5.3357 (0.4); 5.3183 (1.2); 5.3006 (1.8); 5.2829 (1.2); 5.2654 (0.3); 2.3317
(16.0); 2.3174 (0.8); 1.6197 (9.3); 1.6025 (9.2); 1.5833 (1.1); 1.5535 (2.7); −0.0002 (7.1)
I-262: ¹H-NMR(400.1 MHz, d₆-DMSO):
δ = 9.1968 (1.0); 9.1816 (2.2); 9.1664 (1.2); 8.0174 (0.4); 7.9615 (2.5); 7.6816 (1.0); 7.6620 (2.6);
7.6425 (2.0); 7.6050 (2.7); 7.5855 (1.6); 7.4372 (4.2); 7.4141 (1.8); 7.3031 (2.9); 7.2832 (3.2); 7.0767
(3.8); 6.9378 (2.0); 6.9182 (1.9); 4.1145 (1.0); 4.0986 (1.0); 4.0762 (2.1); 4.0608 (2.0); 4.0382 (1.1);
4.0224 (1.1); 3.6060 (3.0); 3.5905 (8.1); 3.5752 (3.5); 3.3110 (66.0); 2.8993 (16.0); 2.7404 (14.6);
2.5135 (13.1); 2.5093 (18.2); 2.5051 (14.2); 2.4193 (0.7); 2.3987 (9.8); 2.2381 (13.2); 2.2170 (1.1);
1.8311 (3.0); 1.8156 (8.0); 1.7998 (3.3)
I-263: ¹H-NMR(400.1 MHz, d₆-DMSO):
δ = 9.0692 (1.5); 9.0538 (3.1); 9.0382 (1.5); 7.9613 (0.7); 7.6298 (1.8); 7.6099 (16.0); 7.5901 (3.0);
7.5790 (6.3); 7.5576 (8.7); 7.4930 (3.4); 7.4736 (2.8); 7.4587 (8.4); 7.4375 (6.1); 7.4036 (4.8); 7.3595
(2.7); 7.3392 (2.3); 7.2265 (2.3); 7.0871 (4.9); 6.9479 (2.4); 4.1347 (1.5); 4.1190 (1.6); 4.0998 (3.4);
4.0841 (3.3); 4.0649 (1.7); 4.0492 (1.6); 3.3121 (24.3); 2.8985 (4.4); 2.7398 (4.0); 2.5130 (11.3);
2.5088 (15.0); 2.5047 (11.5); 2.3265 (0.6); 2.3142 (1.3); 2.3058 (1.4); 2.2936 (2.5); 2.2815 (1.6);
2.2734 (1.4); 2.2610 (0.7); 1.0979 (1.1); 1.0863 (3.1); 1.0800 (4.6); 1.0714 (3.0); 1.0658 (3.1); 1.0595
(4.2); 1.0514 (2.0); 1.0356 (0.5); 1.0304 (0.6); 1.0159 (0.6); 1.0069 (2.0); 0.9984 (4.6); 0.9932 (4.6);
0.9869 (5.2); 0.9807 (4.0); 0.9689 (1.2)
I-264: ¹H-NMR(300.2 MHz, CDCl3):
δ = 8.1230 (5.1); 7.9406 (0.4); 7.9236 (0.7); 7.9067 (0.4); 7.6311 (0.5); 7.6095 (1.0); 7.5872 (0.6);
7.5235 (2.4); 7.4947 (4.1); 7.4219 (4.6); 7.3933 (3.4); 7.3657 (0.6); 7.2987 (6.9); 7.1273 (1.1); 6.9449
(2.2); 6.7626 (1.1); 4.2788 (1.1); 4.2584 (1.0); 4.2322 (2.3); 4.2118 (2.2); 4.1857 (1.1); 4.1652 (1.1);
2.7608 (16.0); 1.6014 (6.1); 1.2949 (0.4); 0.0375 (6.7)
I-265: ¹H-NMR(499.9 MHz, CDCl3):
δ = 7.3701 (2.1); 7.3541 (2.3); 7.3424 (1.2); 7.3261 (2.5); 7.3182 (0.5); 7.3099 (1.7); 7.3020 (0.4);
7.2598 (15.7); 7.2358 (1.8); 7.2199 (1.4); 7.1781 (0.4); 7.1643 (2.8); 7.1144 (0.7); 7.1025 (1.3);
7.0896 (0.9); 7.0805 (1.6); 7.0769 (1.6); 7.0640 (1.4); 7.0604 (1.4); 7.0484 (0.4); 7.0279 (2.7); 6.9395
(1.5); 6.9238 (1.4); 4.6665 (8.7); 4.1999 (0.9); 4.1875 (1.0); 4.1707 (1.9); 4.1582 (1.9); 4.1412 (1.0);
4.1288 (1.0); 3.7261 (2.2); 3.7178 (2.9); 3.7140 (2.4); 3.7089 (3.0); 3.5522 (2.7); 3.5471 (2.3); 3.5433
(3.0); 3.5350 (2.5); 3.5175 (0.5); 3.4794 (0.3); 3.3439 (16.0); 2.4938 (7.2); 2.3820 (0.3); 2.2923 (0.6);
2.2576 (10.3); 1.5632 (5.5); 1.4138 (0.4); 1.2553 (2.8); 1.1072 (1.2); 0.8804 (0.4); 0.8445
(0.3); −0.0002 (14.2)
I-266: ¹H-NMR(400.1 MHz, d₆-DMSO):
δ = 8.9180 (2.2); 7.9597 (0.8); 7.5212 (0.8); 7.5016 (1.7); 7.4805 (1.0); 7.3378 (6.3); 7.3172 (4.0);
7.2350 (1.3); 7.2167 (1.0); 7.2124 (0.9); 7.0470 (2.7); 7.0271 (2.4); 3.3276 (161.0); 2.8982 (4.3);
2.7394 (4.0); 2.5650 (10.1); 2.5088 (7.5); 2.2684 (10.1); 2.2509 (9.2); 1.6144 (16.0)
I-267: ¹H-NMR(499.9 MHz, d₆-DMSO):
δ = 9.2295 (0.9); 9.2178 (1.8); 9.2058 (1.0); 7.6517 (2.7); 7.5629 (2.6); 7.5460 (3.2); 7.3949 (1.8);
7.3909 (1.8); 7.3782 (1.6); 7.3741 (1.6); 7.1788 (0.8); 7.1630 (2.2); 7.1471 (1.6); 7.1109 (0.9); 7.1082
(1.1); 7.0940 (1.6); 7.0805 (0.7); 7.0778 (0.7); 6.9453 (0.9); 6.9323 (1.6); 6.9189 (0.8); 6.0507 (0.5);
6.0421 (0.8); 6.0311 (0.6); 5.9587 (0.5); 5.9500 (0.8); 5.9390 (0.6); 3.9481 (0.5); 3.9356 (0.9); 3.9305
(0.8); 3.9225 (1.0); 3.9112 (0.6); 3.9007 (0.7); 3.8882 (1.0); 3.8833 (0.8); 3.8752 (1.0); 3.8638 (0.6);
3.3192 (5.6); 2.5084 (2.2); 2.5049 (3.2); 2.5015 (2.5); 2.2614 (16.0); 2.0847 (0.6); 2.0781 (0.7);
2.0680 (1.2); 2.0578 (0.8); 2.0512 (0.7); 2.0408 (0.4); 1.9920 (0.4); 1.0403 (0.8); 1.0314 (2.3); 1.0272
(2.5); 1.0189 (1.4); 1.0146 (2.4); 1.0103 (2.6); 1.0022 (1.0); 0.7971 (0.9); 0.7884 (2.6); 0.7849 (2.9);
0.7786 (2.7); 0.7747 (3.0); 0.7657 (1.0)
I-268: ¹H-NMR(400.2 MHz, d₆-DMSO):
δ = 8.7397 (0.6); 8.7255 (1.2); 8.7113 (0.6); 8.0835 (7.9); 7.7511 (0.4); 7.7309 (1.4); 7.7110 (1.6);
7.6964 (3.3); 7.5892 (1.2); 7.5694 (0.9); 6.8436 (2.4); 6.8393 (2.6); 6.7536 (0.8); 6.7492 (0.7); 6.7334
(1.8); 6.7289 (1.7); 6.7042 (3.3); 6.6838 (1.4); 3.9026 (4.1); 3.6965 (16.0); 3.6558 (0.4); 3.6423
(15.8); 3.5436 (0.7); 3.5265 (1.8); 3.5113 (1.9); 3.4943 (0.8); 3.3265 (61.2); 2.7849 (1.4); 2.7673
(2.8); 2.7498 (1.3); 2.6754 (0.5); 2.6710 (0.7); 2.6665 (0.5); 2.5413 (0.9); 2.5242 (2.8); 2.5107 (49.8);
2.5065 (94.9); 2.5020 (119.9); 2.4975 (86.3); 2.4932 (42.7); 2.3333 (0.5); 2.3288 (0.7); 2.3243
(0.5); −0.0002 (0.5)
I-269: ¹H-NMR(300.2 MHz, CDCl3):
δ = 7.6203 (0.6); 7.5944 (2.8); 7.5741 (8.2); 7.5429 (7.7); 7.5358 (10.6); 7.5259 (9.4); 7.5067 (2.5);
7.4945 (2.3); 7.4853 (2.9); 7.4777 (2.1); 7.4725 (1.5); 7.4636 (2.2); 7.4480 (5.2); 7.4416 (5.4); 7.4302
(4.0); 7.4188 (2.4); 7.4155 (2.7); 7.2986 (8.0); 7.2006 (3.3); 7.1740 (4.0); 7.0236 (4.1); 6.9381 (2.3);
6.9117 (1.9); 6.1478 (1.0); 6.1280 (2.0); 6.1080 (1.1); 3.9828 (1.8); 3.9623 (1.7); 3.9336 (3.8); 3.9132
(3.6); 3.8845 (1.9); 3.8641 (1.8); 2.3872 (12.0); 2.3372 (0.4); 2.2882 (16.0); 1.6548 (0.4); 1.3159
(0.6); 1.2969 (1.0); 0.0505 (0.4); 0.0400 (8.7); 0.0292 (0.5)
I-270: ¹H-NMR(400.0 MHz, d₆-DMSO):
δ = 8.8088 (1.6); 8.7948 (3.2); 8.7806 (1.6); 8.0714 (16.0); 8.0706 (15.4); 7.7534 (1.4); 7.7340 (4.4);
7.7144 (4.5); 7.6994 (5.2); 7.6796 (2.0); 7.6452 (5.9); 7.5888 (3.4); 7.5687 (2.6); 7.3850 (1.4); 7.3634
(3.1); 7.3464 (3.1); 7.3248 (1.5); 7.0994 (1.6); 7.0930 (1.7); 7.0737 (2.6); 7.0687 (2.7); 7.0500 (1.7);
7.0436 (1.7); 6.8588 (1.5); 6.8534 (1.5); 6.8376 (2.8); 6.8326 (2.8); 6.8161 (1.4); 6.8114 (1.3); 3.5615
(2.2); 3.5447 (6.1); 3.5293 (6.2); 3.5127 (2.4); 3.3303 (162.0); 2.8747 (3.7); 2.8576 (7.2); 2.8404
(3.3); 2.6762 (0.6); 2.6717 (0.8); 2.5071 (96.4); 2.5026 (126.1); 2.4982 (94.1); 2.3296 (0.7); 1.9891
(1.2); 1.3978 (6.2); 1.1930 (0.3); 1.1755 (0.6); 0.0079 (0.7); −0.0002 (19.0); −0.0079 (0.7)
I-271: ¹H-NMR(300.2 MHz, CDCl3):
δ = 7.7366 (5.4); 7.6624 (1.5); 7.6360 (10.1); 7.6195 (16.0); 7.5077 (10.4); 7.4836 (1.9); 7.4475 (6.3);
7.4405 (5.3); 7.4214 (8.7); 7.3918 (21.3); 7.3728 (20.6); 7.3442 (5.5); 7.3048 (13.4); 7.3022 (17.4);
7.2970 (31.3); 7.2748 (4.0); 7.2131 (8.1); 7.1902 (7.8); 4.1916 (0.4); 4.1713 (0.4); 4.0685 (3.0);
4.0490 (3.0); 4.0202 (6.1); 3.9999 (5.7); 3.9714 (3.2); 3.9511 (2.9); 2.0553 (0.3); 2.0159 (0.5); 2.0043
(0.4); 1.8586 (1.3); 1.7235 (0.4); 1.4819 (0.4); 1.4583 (0.7); 1.4012 (0.3); 1.3713 (0.7); 1.2934 (6.1);
1.1863 (0.5); 1.1560 (0.4); 1.1373 (0.5); 0.9154 (1.1); 0.8944 (1.1); 0.8690 (0.8); 0.0428 (11.7);
0.0401 (15.5); 0.0348 (28.8); 0.0241 (1.1)
I-272: ¹H-NMR(400.1 MHz, d₆-DMSO):
δ = 9.2643 (1.3); 9.2492 (2.8); 9.2339 (1.4); 7.9612 (2.5); 7.6863 (1.2); 7.6666 (3.1); 7.6469 (2.6);
7.6150 (3.3); 7.5954 (1.9); 7.5440 (5.4); 7.5226 (7.2); 7.4356 (4.3); 7.4209 (2.8); 7.3914 (7.4); 7.3701
(5.6); 6.2766 (2.5); 6.2525 (2.6); 4.1406 (1.0); 4.1256 (1.1); 4.1043 (2.2); 4.0891 (2.1); 4.0675 (1.3);
4.0521 (1.2); 3.5605 (0.4); 3.5344 (1.0); 3.5186 (0.8); 3.5087 (1.1); 3.4839 (0.4); 3.3120 (98.3);
2.8992 (16.0); 2.7403 (14.3); 2.5136 (16.2); 2.5092 (22.5); 2.5049 (17.2); 1.8689 (2.0); 1.8433 (2.3);
1.7307 (1.9); 1.6988 (2.3); 1.5916 (1.1); 1.5605 (1.2); 1.4838 (0.7); 1.4591 (1.9); 1.4270 (2.0); 1.4017
(0.9); 1.2509 (0.7); 1.2211 (1.8); 1.1890 (2.0); 1.1565 (1.3); 1.1165 (1.2); 1.0862 (0.8)
I-273: ¹H-NMR(400.1 MHz, d₆-DMSO):
δ = 9.2211 (1.5); 9.2074 (3.2); 9.1933 (1.5); 7.9963 (16.0); 7.9608 (1.6); 7.8686 (6.5); 7.8652 (6.7);
7.6712 (2.0); 7.6516 (4.8); 7.6318 (3.1); 7.5415 (4.1); 7.5220 (3.1); 7.5023 (4.7); 7.4811 (7.4); 7.4446
(5.8); 7.4102 (6.9); 7.3893 (5.2); 7.2475 (2.7); 7.1082 (5.9); 6.9690 (2.9); 4.2954 (1.5); 4.2814 (1.6);
4.2615 (3.2); 4.2468 (3.2); 4.2265 (1.7); 4.2127 (1.6); 3.3114 (35.9); 2.8987 (9.4); 2.7397 (8.4);
2.5130 (15.6); 2.5088 (20.9); 2.5046 (15.9)
I-274: ¹H-NMR(400.0 MHz, d₆-DMSO):
δ = 9.1771 (3.2); 9.1558 (3.3); 8.2294 (16.0); 7.7495 (1.2); 7.7297 (3.8); 7.7103 (3.8); 7.6909 (6.4);
7.6667 (2.1); 7.6443 (3.4); 7.6247 (2.1); 7.4898 (5.5); 7.4861 (5.7); 7.3420 (3.0); 7.3370 (2.8); 7.3216
(3.5); 7.3166 (3.4); 7.0957 (5.2); 7.0752 (4.4); 5.2002 (0.8); 5.1801 (2.0); 5.1627 (1.5); 5.1470 (0.7);
3.3396 (101.4); 2.7093 (4.4); 2.6937 (2.8); 2.6758 (0.7); 2.6714 (0.8); 2.6666 (0.7); 2.5417 (70.0);
2.5066 (76.4); 2.5023 (100.1); 2.4980 (73.0); 2.3293 (0.5); 2.3245 (0.4); 2.0612 (0.6); 2.0471 (1.4);
2.0366 (1.4); 2.0289 (1.1); 2.0188 (1.4); 2.0045 (0.9); 1.8964 (0.8); 1.8783 (1.2); 1.8652 (1.7); 1.8536
(1.3); 1.8322 (0.5); 1.8169 (0.5); 1.7991 (0.9); 1.7788 (1.5); 1.7646 (2.5); 1.7499 (2.7); 1.7252 (1.1);
1.7021 (0.4); 1.6962 (0.4); −0.0004 (4.3)
I-275: ¹H-NMR(400.1 MHz, d₆-DMSO):
δ = 9.2783 (0.9); 9.2625 (1.9); 9.2471 (1.0); 8.8532 (6.2); 8.7171 (3.4); 8.7047 (3.6); 8.2810 (0.3);
8.1579 (6.9); 8.0315 (1.5); 7.9596 (2.7); 7.7818 (0.3); 7.7526 (0.3); 7.7257 (3.2); 7.7134 (3.2); 7.6995
(0.8); 7.6801 (1.6); 7.6611 (1.7); 7.6440 (1.7); 7.6278 (1.3); 7.6024 (0.7); 7.5221 (1.4); 7.5021 (2.2);
7.4821 (1.0); 7.4725 (0.6); 7.4543 (1.5); 7.3396 (2.4); 7.3195 (5.4); 7.3070 (0.8); 7.2962 (0.8); 7.1845
(1.4); 7.1613 (0.3); 7.0750 (3.5); 6.9378 (1.8); 6.9189 (1.7); 4.1719 (0.8); 4.1563 (0.9); 4.1355 (1.9);
4.1198 (1.9); 4.0993 (1.3); 4.0833 (1.2); 3.3279 (453.0); 2.8982 (16.0); 2.7392 (14.8); 2.5128 (14.9);
2.5089 (19.4); 2.5050 (14.8); 2.4401 (8.2); 2.3526 (0.5); 2.3053 (0.7); 2.2816 (0.8); 2.1959 (11.5);
2.1663 (0.8)
I-276: ¹H-NMR(600.1 MHz, CD3CN):
δ = 7.9139 (16.0); 7.6812 (1.1); 7.6681 (3.8); 7.6551 (8.7); 7.6444 (0.9); 7.6418 (1.0); 7.3806 (4.4);
7.2973 (0.4); 7.2785 (1.8); 7.2753 (3.5); 7.2718 (2.5); 7.2633 (3.5); 7.2601 (2.7); 7.2391 (0.4); 7.1961
(0.9); 7.1919 (8.2); 7.1892 (3.3); 7.1780 (10.0); 7.1740 (1.8); 7.0453 (1.2); 7.0409 (11.3); 7.0376
(3.7); 7.0300 (3.0); 7.0267 (9.2); 7.0224 (1.2); 3.3253 (0.9); 3.3176 (1.9); 3.3125 (2.0); 3.3101 (1.3);
3.3049 (3.8); 3.2997 (1.3); 3.2973 (2.1); 3.2922 (2.0); 3.2846 (1.0); 2.4204 (1.2); 2.4079 (2.5); 2.3935
(2.6); 2.3810 (1.3); 2.1325 (35.2); 1.9633 (1.0); 1.9552 (2.3); 1.9511 (2.7); 1.9472 (15.4); 1.9431
(26.9); 1.9390 (39.3); 1.9349 (27.1); 1.9308 (14.0); 1.4302 (2.0); 1.4196 (2.5); 1.4176 (2.5); 1.4152
(2.3); 1.4070 (2.4); 1.4045 (2.7); 1.4026 (2.4); 1.3920 (2.1); 1.3877 (2.1); 1.2424 (2.0); 1.2348 (2.2);
1.2313 (3.2); 1.2237 (3.2); 1.2204 (2.1); 1.2127 (1.8); −0.0001 (2.4)
I-277: ¹H-NMR(400.1 MHz, CDCl3):
δ = 8.2798 (8.4); 7.8974 (1.0); 7.6259 (4.8); 7.6130 (4.6); 7.4474 (2.9); 7.4305 (0.4); 7.4211 (1.2);
7.4147 (1.2); 7.4082 (1.6); 7.4032 (1.4); 7.3987 (1.1); 7.3924 (0.8); 7.3233 (3.4); 7.2968 (2.5); 7.2861
(1.6); 7.2675 (3.0); 7.2595 (7.6); 7.2485 (2.1); 7.2410 (2.4); 7.2227 (0.8); 4.2218 (1.5); 4.2070 (1.4);
4.1861 (3.0); 4.1713 (3.0); 4.1504 (1.5); 4.1355 (1.5); 2.3340 (16.0); 1.5582 (2.5); −0.0002 (6.2)
I-278: ¹H-NMR(400.0 MHz, d₆-DMSO):
δ = 9.2497 (0.8); 9.2342 (1.7); 9.2187 (0.8); 8.0383 (7.8); 8.0149 (5.1); 7.9530 (0.4); 7.7505 (4.8);
7.7297 (4.2); 7.6994 (1.8); 7.6795 (2.4); 7.6642 (5.3); 7.6597 (5.2); 7.5845 (1.8); 7.5625 (3.0); 7.5416
(2.9); 7.5133 (0.3); 7.4620 (1.7); 7.4408 (1.1); 7.3402 (0.4); 4.2107 (0.7); 4.1948 (0.7); 4.1736 (1.5);
4.1580 (1.5); 4.1372 (0.8); 4.1211 (0.9); 3.8864 (16.0); 3.3310 (194.3); 2.8914 (2.2); 2.7487 (0.3);
2.7322 (2.0); 2.6759 (0.6); 2.6719 (0.8); 2.6675 (0.6); 2.5526 (7.3); 2.5071 (103.9); 2.5027 (133.0);
2.4984 (98.7); 2.4517 (0.9); 2.3339 (0.6); 2.3292 (0.8); 2.3252 (0.6); 1.2399 (0.8); −0.0002 (0.3)
I-279: ¹H-NMR(300.2 MHz, CDCl3):
δ = 7.5642 (0.4); 7.5381 (1.6); 7.5172 (7.1); 7.4883 (4.4); 7.4232 (2.2); 7.3974 (4.0); 7.3684 (3.2);
7.3582 (1.7); 7.3509 (1.0); 7.3446 (0.6); 7.3362 (0.9); 7.3292 (0.5); 7.2986 (2.2); 7.0356 (0.6); 7.0149
(1.1); 6.9942 (0.6); 4.2035 (1.0); 4.1825 (1.0); 4.1556 (2.1); 4.1345 (2.0); 4.1076 (1.1); 4.0865 (1.0);
2.7807 (2.6); 2.5718 (9.3); 2.5584 (16.0); 2.2061 (15.8); 1.9799 (0.4); 1.7622 (0.5); 1.2892 (0.4);
0.0326 (2.1)
I-280: ¹H-NMR(300.2 MHz, CDCl3):
δ = 10.0222 (6.0); 7.6718 (1.9); 7.6521 (3.5); 7.6322 (2.2); 7.6171 (7.2); 7.6119 (6.1); 7.6069 (5.8);
7.5993 (15.2); 7.5960 (16.0); 7.5853 (1.4); 7.5808 (1.3); 7.5636 (0.4); 7.5520 (0.3); 7.5321 (0.4);
7.4791 (1.6); 7.4581 (10.5); 7.4476 (10.5); 7.4185 (20.5); 7.3946 (13.7); 7.3904 (9.9); 7.3783 (5.7);
7.3687 (11.7); 7.3605 (5.0); 7.3519 (2.7); 7.3348 (14.8); 7.3061 (12.0); 7.2986 (16.2); 7.2924 (2.5);
7.2852 (6.5); 7.2781 (1.7); 7.2604 (2.1); 7.1143 (11.3); 7.0891 (9.4); 4.1926 (0.9); 4.1688 (2.7);
4.1449 (2.7); 4.1212 (1.0); 4.1008 (0.4); 4.0284 (4.0); 4.0082 (3.9); 3.9817 (8.6); 3.9615 (8.3); 3.9351
(4.4); 3.9149 (4.2); 3.1937 (0.5); 2.7896 (4.2); 2.0809 (13.1); 1.6715 (0.7); 1.6502 (0.6); 1.6229 (0.4);
1.3472 (0.4); 1.3201 (3.6); 1.2962 (8.9); 1.2725 (3.4); 0.9980 (0.4); 0.9736 (0.7); 0.9489 (0.4); 0.9432
(0.3); 0.9211 (0.9); 0.8975 (0.4); 0.0506 (0.4); 0.0398 (13.7); 0.0287 (0.5)
I-281: ¹H-NMR(400.1 MHz, d₆-DMSO):
δ = 9.0686 (1.5); 9.0537 (3.2); 9.0387 (1.5); 7.9611 (0.9); 7.6320 (1.9); 7.6069 (16.0); 7.6011 (7.9);
7.5796 (9.9); 7.5060 (10.2); 7.4846 (7.2); 7.4781 (3.4); 7.4078 (5.3); 7.3603 (3.0); 7.3399 (2.6);
7.2282 (2.5); 7.0889 (5.5); 6.9496 (2.7); 4.1280 (1.5); 4.1128 (1.6); 4.0932 (3.3); 4.0780 (3.2); 4.0581
(1.8); 4.0430 (1.6); 3.3118 (30.2); 2.8985 (5.5); 2.7397 (4.9); 2.5130 (13.9); 2.5088 (18.5); 2.5045
(13.9); 2.3267 (0.7); 2.3142 (1.4); 2.3056 (1.6); 2.2935 (2.9); 2.2816 (1.8); 2.2731 (1.5); 2.2609 (0.8);
1.0984 (1.3); 1.0869 (3.4); 1.0805 (5.2); 1.0719 (3.4); 1.0663 (3.5); 1.0600 (4.6); 1.0518 (2.2); 1.0361
(0.6); 1.0303 (0.6); 1.0162 (0.7); 1.0069 (2.2); 0.9984 (5.1); 0.9932 (5.1); 0.9868 (5.7); 0.9807 (4.5);
0.9689 (1.4)
I-282: ¹H-NMR(300.2 MHz, CDCl3):
δ = 8.8914 (0.5); 8.1878 (1.4); 8.1399 (4.6); 7.7186 (0.8); 7.7153 (0.7); 7.6948 (0.9); 7.6917 (0.9);
7.6882 (0.8); 7.3665 (1.0); 7.3405 (2.2); 7.3141 (1.4); 7.2988 (12.6); 7.2731 (1.4); 7.0395 (1.2);
7.0136 (1.1); 6.9257 (0.8); 6.9227 (0.8); 6.9178 (1.1); 6.9148 (1.0); 6.8993 (0.5); 6.8914 (1.3); 6.8879
(1.5); 6.8841 (1.8); 6.8782 (2.0); 6.8712 (0.9); 6.7172 (1.0); 6.5310 (2.0); 6.3448 (1.0); 5.3368 (2.0);
4.1700 (0.7); 4.1462 (0.7); 4.0358 (0.9); 4.0166 (2.0); 4.0059 (0.7); 3.9959 (2.0); 3.9764 (1.0); 3.2272
(1.2); 3.2068 (1.9); 3.1869 (1.2); 2.7329 (15.0); 2.0825 (3.8); 2.0449 (1.7); 1.9703 (0.5); 1.9592 (0.5);
1.9424 (1.0); 1.9256 (0.6); 1.9143 (0.5); 1.6292 (16.0); 1.3198 (1.0); 1.2959 (2.0); 1.2721 (0.9);
1.0525 (0.7); 1.0373 (1.7); 1.0305 (1.9); 1.0249 (1.0); 1.0155 (1.0); 1.0088 (1.8); 1.0023 (1.6); 0.9876
(0.9); 0.7629 (0.8); 0.7476 (2.1); 0.7415 (1.9); 0.7311 (1.8); 0.7253 (2.3); 0.7091 (0.6); 0.1057 (1.5);
0.0465 (0.4); 0.0358 (12.0); 0.0249 (0.5)
I-283: ¹H-NMR(300.2 MHz, CDCl3):
δ = 8.1101 (5.1); 7.9129 (0.4); 7.8936 (0.7); 7.8737 (0.4); 7.6676 (1.9); 7.6647 (2.0); 7.6351 (0.5);
7.6115 (1.0); 7.5897 (0.6); 7.5380 (0.5); 7.5099 (2.3); 7.4813 (3.5); 7.4423 (1.8); 7.4364 (1.7); 7.4248
(1.1); 7.4142 (0.9); 7.4082 (0.8); 7.3979 (1.4); 7.3708 (0.5); 7.2987 (9.0); 7.1322 (1.1); 6.9499 (2.2);
6.7675 (1.1); 5.3368 (1.2); 4.5031 (1.0); 4.4824 (1.0); 4.4559 (2.2); 4.4352 (2.1); 4.4086 (1.1); 4.3879
(1.0); 2.7532 (16.0); 1.5970 (8.1); 1.2945 (0.6); 0.1076 (0.7); 0.0482 (0.3); 0.0374 (8.9); 0.0265 (0.4)
I-284: ¹H-NMR(300.2 MHz, CDCl3):
δ = 8.0486 (0.8); 7.5807 (1.8); 7.5764 (2.6); 7.5719 (1.7); 7.4117 (1.1); 7.3841 (3.9); 7.3679 (2.8);
7.3621 (2.4); 7.3400 (0.7); 7.3341 (0.7); 7.2983 (16.9); 7.1332 (0.5); 7.1250 (0.4); 7.1098 (3.6);
7.0976 (2.0); 7.0937 (2.0); 7.0903 (2.3); 7.0847 (2.9); 7.0669 (0.4); 6.8353 (0.7); 6.8221 (0.7); 6.8146
(1.1); 6.8030 (1.2); 6.7906 (0.6); 6.7814 (0.6); 6.5242 (0.5); 6.5039 (0.8); 6.4836 (0.5); 6.0940 (0.5);
6.0833 (0.6); 6.0725 (0.6); 6.0619 (0.5); 5.9398 (0.5); 5.9286 (0.6); 5.9182 (0.6); 5.9071 (0.5); 4.2207
(0.4); 4.2098 (0.4); 4.1992 (0.4); 4.1875 (0.6); 4.1374 (0.4); 4.1265 (0.4); 4.1158 (0.4); 4.1048 (0.4);
4.0206 (0.4); 4.0005 (0.6); 3.9795 (0.4); 3.9720 (0.3); 3.9510 (0.5); 3.9428 (0.4); 3.9305 (0.3); 3.9227
(0.6); 3.9016 (0.4); 3.8940 (0.3); 3.8734 (0.5); 3.8525 (0.4); 2.9917 (6.8); 2.9179 (5.8); 2.9164 (5.4);
2.6317 (16.0); 2.6191 (1.6); 2.4618 (0.4); 2.3537 (1.3); 2.3368 (15.9); 2.1340 (0.6); 2.1232 (0.6);
2.1057 (1.1); 2.0883 (0.6); 2.0774 (0.6); 2.0602 (0.4); 1.2925 (0.4); 1.0627 (0.8); 1.0476 (2.1); 1.0407
(2.3); 1.0346 (1.2); 1.0261 (1.3); 1.0190 (2.3); 1.0124 (2.1); 0.9979 (1.1); 0.8146 (1.1); 0.7998 (2.5);
0.7969 (2.2); 0.7938 (2.4); 0.7826 (2.2); 0.7772 (2.6); 0.7607 (0.9); 0.0479 (0.7); 0.0371 (20.8);
0.0261 (0.9)
I-285: ¹H-NMR(499.9 MHz, CDCl3):
δ = 7.5413 (0.4); 7.5256 (2.0); 7.5127 (5.1); 7.4441 (0.5); 7.4320 (2.3); 7.3927 (0.4); 7.3840 (1.0);
7.3792 (1.6); 7.3751 (1.2); 7.3660 (1.1); 7.3492 (0.5); 7.3408 (2.0); 7.3339 (0.6); 7.3248 (2.2); 7.2597
(6.0); 7.0387 (3.0); 6.9582 (2.6); 6.9443 (2.0); 5.2972 (2.1); 4.5276 (1.1); 4.5213 (1.2); 4.5063 (1.5);
4.5000 (1.5); 4.3956 (1.4); 4.3824 (1.5); 4.3744 (1.1); 4.3611 (1.1); 4.2179 (0.6); 4.2052 (0.6); 4.1883
(0.9); 4.1756 (1.0); 4.1538 (1.0); 4.1416 (1.0); 4.1236 (1.3); 4.1119 (1.5); 3.8576 (0.3); 3.5145 (4.7);
3.5038 (4.6); 3.3943 (16.0); 3.3648 (3.0); 3.3529 (1.0); 2.4705 (7.8); 2.2826 (9.8); 1.5840 (1.2);
1.2558 (0.4); −0.0002 (6.1)
I-286: ¹H-NMR(400.2 MHz, d₆-DMSO):
δ = 8.8440 (1.2); 8.8297 (2.3); 8.8153 (1.2); 8.3150 (0.5); 8.0710 (16.0); 7.7418 (1.1); 7.7225 (3.4);
7.7030 (3.7); 7.6910 (4.1); 7.6713 (1.4); 7.6376 (4.4); 7.5752 (2.6); 7.5554 (1.9); 7.2116 (1.2); 7.2036
(1.4); 7.1969 (1.4); 7.1889 (2.5); 7.1809 (1.4); 7.1742 (1.3); 7.1663 (1.3); 7.1420 (1.1); 7.1305 (1.2);
7.1192 (2.6); 7.1076 (2.6); 7.0961 (1.7); 7.0846 (1.6); 7.0339 (0.9); 7.0246 (1.4); 7.0141 (1.4); 7.0039
(2.0); 6.9957 (1.1); 6.9822 (0.9); 6.9734 (0.5); 3.9029 (0.9); 3.5966 (1.8); 3.5799 (4.8); 3.5646 (4.9);
3.5481 (1.9); 3.3286 (95.0); 2.8954 (2.8); 2.8785 (5.5); 2.8618 (2.6); 2.6760 (0.8); 2.6714 (1.0);
2.6669 (0.8); 2.6622 (0.4); 2.5249 (3.9); 2.5200 (6.2); 2.5115 (70.3); 2.5071 (137.6); 2.5026 (175.9);
2.4980 (124.7); 2.4935 (59.6); 2.3339 (0.7); 2.3293 (1.0); 2.3248 (0.7); 2.3204 (0.4); 1.3383 (0.4);
1.3206 (0.6); 1.3028 (0.3); 1.2442 (0.4); 1.2349 (0.3); −0.0002 (0.8)
I-287: ¹H-NMR(300.2 MHz, CDCl3):
δ = 8.2968 (11.8); 7.8416 (0.8); 7.8237 (1.4); 7.8055 (0.8); 7.3728 (3.4); 7.3463 (4.0); 7.3048 (2.9);
7.1670 (1.4); 7.1608 (2.4); 7.1536 (1.7); 7.1396 (1.4); 7.1335 (2.5); 7.1262 (1.7); 7.0908 (5.3); 7.0862
(4.7); 7.0799 (3.8); 7.0737 (1.7); 7.0242 (2.2); 6.9976 (1.9); 6.9514 (1.6); 6.9440 (2.8); 6.9367 (1.4);
6.9222 (1.6); 6.9148 (2.8); 6.9075 (1.4); 4.2977 (1.9); 4.2780 (1.8); 4.2497 (4.0); 4.2299 (3.9); 4.2017
(2.0); 4.1819 (1.9); 2.5121 (11.6); 2.5049 (6.5); 2.3510 (16.0); 1.6531 (4.2); 0.0442 (2.6)
I-288: ¹H-NMR(300.2 MHz, CDCl3):
δ = 8.0859 (10.8); 8.0260 (1.2); 7.6760 (0.4); 7.6488 (2.3); 7.6282 (6.6); 7.6123 (0.6); 7.5162 (2.9);
7.4801 (0.4); 7.4609 (4.1); 7.4534 (2.4); 7.4462 (1.8); 7.4321 (8.5); 7.4256 (3.9); 7.2986 (70.9);
7.2658 (2.8); 7.2590 (2.6); 7.2380 (2.0); 7.2312 (1.9); 6.9478 (0.4); 6.1430 (0.8); 6.1320 (0.9); 6.1190
(0.8); 6.1083 (0.8); 5.9879 (0.9); 5.9765 (0.8); 5.9640 (0.9); 5.9530 (0.8); 5.3382 (15.6); 4.3547 (0.5);
4.3446 (0.5); 4.3330 (0.4); 4.3215 (0.5); 4.3062 (0.6); 4.2954 (0.7); 4.2837 (0.6); 4.2727 (0.6); 4.2654
(0.6); 4.2539 (0.5); 4.2424 (0.5); 4.2313 (0.5); 4.2163 (0.6); 4.2056 (0.6); 4.1939 (0.7); 4.1829 (0.6);
3.9083 (0.5); 3.8913 (0.6); 3.8849 (0.6); 3.8675 (0.6); 3.8596 (0.5); 3.8368 (1.0); 3.8197 (1.0); 3.7964
(0.6); 3.7885 (0.6); 3.7715 (0.6); 3.7650 (0.6); 3.7478 (0.4); 2.2941 (0.5); 2.2765 (0.8); 2.2678 (1.0);
2.2597 (0.7); 2.2505 (2.1); 2.2396 (0.8); 2.2315 (0.9); 2.2248 (1.1); 2.2061 (0.5); 2.0837 (1.6); 2.0456
(1.5); 1.5762 (16.0); 1.3216 (0.4); 1.2979 (0.8); 1.2096 (1.7); 1.2010 (4.8); 1.1918 (5.2); 1.1871 (7.4);
1.1791 (4.1); 1.1666 (2.8); 1.1609 (4.3); 1.1520 (2.0); 1.1298 (0.4); 0.0492 (3.0); 0.0384 (79.1);
0.0275 (3.1); −0.1600 (0.3)
I-289: ¹H-NMR(400.1 MHz, d₆-DMSO):
δ = 9.1846 (0.4); 9.1693 (0.8); 9.1540 (0.4); 7.9611 (0.6); 7.7189 (0.3); 7.6991 (1.0); 7.6795 (0.8);
7.6528 (1.0); 7.6333 (0.5); 7.5756 (1.6); 7.5543 (2.2); 7.4724 (1.3); 7.4589 (0.8); 7.4313 (2.4); 7.4099
(1.6); 4.2009 (0.4); 4.1856 (0.4); 4.1649 (0.8); 4.1494 (0.8); 4.1287 (0.4); 4.1132 (0.4); 3.3110 (23.5);
2.9058 (16.0); 2.8994 (5.5); 2.7399 (3.8); 2.5134 (4.4); 2.5091 (6.1); 2.5047 (4.5)
I-290: ¹H-NMR(400.1 MHz, d₆-DMSO):
δ = 9.0737 (1.2); 9.0585 (2.4); 9.0431 (1.2); 7.9611 (0.6); 7.6277 (1.4); 7.6080 (3.3); 7.5883 (2.2);
7.5678 (10.1); 7.4884 (2.8); 7.4692 (2.1); 7.4021 (4.0); 7.3682 (2.3); 7.3480 (2.0); 7.3242 (3.5);
7.3042 (3.8); 7.2268 (1.9); 7.0870 (7.1); 6.9619 (2.4); 6.9478 (3.0); 4.1144 (1.2); 4.0989 (1.2); 4.0777
(2.6); 4.0621 (2.6); 4.0405 (1.4); 4.0250 (1.3); 3.3119 (21.2); 2.8985 (3.6); 2.7398 (3.2); 2.5130 (9.8);
2.5088 (13.1); 2.5046 (10.0); 2.4245 (11.5); 2.3261 (0.5); 2.3139 (1.1); 2.3055 (1.3); 2.2934 (2.2);
2.2814 (1.4); 2.2729 (1.2); 2.2610 (0.9); 2.2362 (16.0); 2.1863 (0.4); 1.1017 (0.9); 1.0903 (2.6);
1.0838 (3.8); 1.0751 (2.4); 1.0697 (2.7); 1.0634 (3.5); 1.0550 (1.6); 1.0390 (0.5); 1.0262 (0.4); 1.0191
(0.4); 1.0025 (1.6); 0.9938 (3.8); 0.9884 (3.8); 0.9823 (4.2); 0.9761 (3.4); 0.9644 (1.0)
I-291: ¹H-NMR(600.4 MHz, d₆-DMSO):
δ = 8.7712 (0.8); 8.7615 (1.5); 8.7519 (0.7); 8.1155 (1.2); 8.0769 (9.3); 7.8052 (4.3); 7.8023 (4.4);
7.7212 (3.0); 7.0755 (0.4); 7.0622 (0.4); 7.0538 (2.5); 7.0410 (2.8); 6.9820 (0.4); 6.9426 (2.9); 6.8398
(1.5); 6.8267 (1.4); 5.7519 (1.3); 3.4713 (1.2); 3.4605 (2.2); 3.4475 (2.2); 3.4372 (1.3); 3.4240 (0.3);
3.4088 (0.3); 3.3409 (0.3); 3.3075 (333.4); 3.2861 (0.6); 2.8080 (2.1); 2.7954 (3.3); 2.7835 (2.0);
2.6153 (1.3); 2.6123 (1.8); 2.6093 (1.2); 2.6062 (0.6); 2.5213 (3.2); 2.5182 (3.9); 2.5151 (3.9); 2.5063
(105.8); 2.5033 (221.5); 2.5003 (303.0); 2.4973 (220.7); 2.4943 (104.7); 2.3873 (1.3); 2.3842 (1.8);
2.3812 (1.3); 2.2817 (0.6); 2.2763 (2.1); 2.2646 (16.0); 2.2333 (2.2); 2.2234 (0.6); 2.1938 (13.7);
1.9073 (0.4); 1.2588 (0.4); 1.2366 (0.4); 0.8763 (0.6); 0.8632 (0.5); 0.0053 (0.8); −0.0001
(29.2); −0.0057 (1.0)
I-292: ¹H-NMR(400.1 MHz, d₆-DMSO):
δ = 9.1727 (1.8); 9.1572 (3.6); 9.1413 (1.7); 8.5198 (16.0); 7.9590 (2.2); 7.8018 (1.3); 7.7825 (4.1);
7.7624 (6.1); 7.7561 (5.9); 7.7365 (1.8); 7.7090 (5.8); 7.6321 (3.6); 7.6132 (2.8); 7.5871 (7.7); 7.5657
(9.6); 7.4239 (9.3); 7.4027 (7.3); 4.1895 (1.8); 4.1738 (1.9); 4.1549 (3.9); 4.1392 (3.8); 4.1200 (2.0);
4.1042 (1.9); 3.3172 (71.1); 2.8968 (14.2); 2.7373 (12.6); 2.6806 (0.8); 2.6763 (1.0); 2.5116 (110.7);
2.5073 (141.1); 2.5030 (102.6); 2.3385 (0.6); 2.3342 (0.8); 2.3298 (0.6)
I-293: ¹H-NMR(400.1 MHz, CDCl3):
δ = 7.5531 (0.5); 7.5341 (1.5); 7.5150 (3.2); 7.4926 (0.7); 7.4742 (2.2); 7.4329 (1.0); 7.4281 (1.4);
7.4099 (0.9); 7.3216 (0.9); 7.3090 (0.5); 7.2594 (8.3); 7.0747 (1.7); 7.0555 (2.2); 6.9851 (2.4); 6.9376
(1.4); 6.9186 (1.0); 3.7538 (1.1); 3.7365 (2.6); 3.7212 (2.6); 3.7039 (1.1); 3.6803 (1.9); 3.6661 (3.4);
3.6518 (2.0); 3.1548 (16.0); 2.9951 (2.1); 2.9807 (3.4); 2.9667 (1.9); 2.9325 (1.8); 2.9150 (3.4);
2.8974 (1.6); 2.3146 (11.8); 2.3011 (0.5); 2.2701 (10.9); 1.5593 (12.8); −0.0002 (4.8)
I-294: ¹H-NMR(300.2 MHz, CDCl3):
δ = 7.5688 (0.3); 7.5429 (1.2); 7.5185 (2.8); 7.4904 (0.4); 7.4549 (2.0); 7.4306 (0.9); 7.4235 (1.3);
7.4166 (0.7); 7.3993 (0.9); 7.3905 (2.0); 7.3635 (1.9); 7.2986 (4.2); 7.0856 (1.9); 7.0004 (1.0); 6.9740
(0.9); 6.4226 (0.4); 6.4025 (0.8); 6.3823 (0.5); 4.2819 (0.9); 4.2611 (0.9); 4.2452 (0.4); 4.2333 (2.0);
4.2124 (1.9); 4.1847 (1.1); 4.1638 (1.1); 4.1408 (1.2); 4.1290 (0.4); 4.1258 (0.4); 4.0981 (16.0);
2.5283 (5.9); 2.3794 (0.5); 2.3277 (7.5); 2.2898 (1.1); 2.2246 (15.8); 1.6079 (3.1); 1.2950 (0.7);
0.9202 (0.4); 0.0382 (4.0)
I-295: ¹H-NMR(400.1 MHz, d₆-DMSO):
δ = 8.9917 (1.8); 8.9774 (3.8); 8.9629 (1.9); 7.9609 (1.9); 7.6527 (16.0); 7.6457 (7.6); 7.6294 (2.4);
7.6095 (5.0); 7.5898 (3.4); 7.5681 (5.6); 7.5471 (7.2); 7.5335 (0.4); 7.4899 (4.3); 7.4707 (3.3); 7.4190
(6.1); 7.4037 (4.7); 7.3988 (4.5); 7.3825 (6.4); 7.3779 (6.6); 7.3601 (3.0); 7.2234 (2.9); 7.0841 (6.1);
6.9448 (3.0); 6.0565 (1.2); 6.0438 (2.3); 6.0309 (1.3); 5.9407 (1.2); 5.9286 (2.2); 5.9153 (1.3); 3.8813
(1.8); 3.8696 (3.6); 3.8552 (2.3); 3.8287 (1.6); 3.8222 (1.7); 3.8133 (3.1); 3.7983 (1.9); 3.3117 (38.9);
2.8986 (11.4); 2.7398 (10.4); 2.5130 (15.9); 2.5088 (21.3); 2.5047 (16.3); 2.3308 (0.8); 2.3184 (1.6);
2.3099 (1.8); 2.2978 (3.2); 2.2858 (2.0); 2.2774 (1.8); 2.2651 (0.9); 1.1048 (1.4); 1.0932 (3.9); 1.0868
(5.8); 1.0782 (3.8); 1.0726 (4.0); 1.0664 (5.2); 1.0582 (2.5); 1.0420 (0.7); 1.0368 (0.7); 1.0219 (0.7);
1.0131 (2.5); 1.0045 (5.7); 0.9992 (5.9); 0.9929 (6.5); 0.9868 (5.2); 0.9749 (1.6)
I-296: ¹H-NMR(300.2 MHz, CDCl3):
δ = 7.5955 (0.7); 7.5741 (2.4); 7.5383 (1.1); 7.5021 (0.5); 7.4928 (0.8); 7.4854 (0.5); 7.4707 (0.4);
7.4262 (2.0); 7.4047 (0.8); 7.3986 (2.4); 7.2987 (7.2); 7.1871 (1.8); 7.1605 (1.5); 6.3481 (0.9); 2.9875
(0.7); 2.9088 (0.6); 2.4717 (11.0); 2.3629 (6.9); 1.8664 (16.0); 1.5877 (2.4); 0.1091 (0.5); 0.0392 (7.0)
I-297: ¹H-NMR(400.2 MHz, d₆-DMSO):
δ = 9.0483 (1.2); 9.0337 (2.6); 9.0190 (1.3); 8.3366 (0.8); 8.1057 (16.0); 7.7857 (0.9); 7.7660 (2.8);
7.7466 (2.6); 7.7286 (3.5); 7.7108 (5.7); 7.6253 (2.3); 7.6049 (1.9); 7.5403 (5.5); 7.5197 (7.5); 7.4117
(6.9); 7.3907 (5.1); 5.8117 (0.8); 5.8004 (1.1); 5.7957 (1.0); 5.7844 (0.9); 5.7768 (3.7); 5.6937 (0.8);
5.6829 (1.1); 5.6773 (1.0); 5.6667 (0.9); 5.2375 (0.5); 3.8897 (0.4); 3.8695 (0.8); 3.8537 (1.5); 3.8384
(1.4); 3.8316 (1.1); 3.8284 (1.1); 3.8181 (1.4); 3.8032 (1.3); 3.7959 (0.5); 3.7871 (0.9); 3.7819 (1.0);
3.7676 (1.0); 3.7567 (0.8); 3.7463 (0.3); 3.7317 (0.3); 3.3428 (118.6); 3.3197 (0.4); 2.7025 (0.4);
2.6980 (0.8); 2.6935 (1.1); 2.6889 (0.8); 2.6842 (0.4); 2.5470 (3.1); 2.5423 (4.5); 2.5335 (59.7);
2.5290 (125.1); 2.5243 (174.4); 2.5198 (133.4); 2.5153 (66.2); 2.3603 (0.4); 2.3558 (0.8); 2.3513
(1.1); 2.3467 (0.8); 2.3423 (0.4); 1.2818 (0.5); 1.2569 (6.8); 0.8766 (0.6); 0.0225 (0.6); −0.0002 (2.9)
I-298: ¹H-NMR(400.1 MHz, d₆-DMSO):
δ = 9.2285 (1.8); 9.2131 (3.6); 9.1974 (1.7); 8.4844 (16.0); 7.9589 (1.9); 7.8676 (6.2); 7.8638 (6.4);
7.8061 (1.4); 7.7865 (4.2); 7.7669 (5.2); 7.7585 (5.7); 7.7388 (1.8); 7.7062 (5.9); 7.6227 (3.4); 7.6034
(2.6); 7.5081 (5.0); 7.4869 (6.9); 7.3799 (3.9); 7.3758 (3.9); 7.3590 (2.9); 7.3546 (2.9); 4.3265 (1.7);
4.3106 (1.8); 4.2917 (3.7); 4.2760 (3.6); 4.2568 (1.9); 4.2411 (1.8); 3.3730 (0.3); 3.3171 (77.4);
2.8969 (12.0); 2.7374 (10.7); 2.6765 (1.0); 2.6717 (0.8); 2.5117 (125.2); 2.5074 (163.0); 2.5031
(119.8); 2.3386 (0.7); 2.3342 (1.0); 2.3298 (0.7)
I-299: ¹H-NMR(400.0 MHz, d₆-DMSO):
δ = 9.2141 (0.9); 9.1984 (1.9); 9.1826 (0.9); 8.1057 (5.0); 8.0262 (8.7); 7.9525 (2.2); 7.8244 (5.6);
7.7281 (0.6); 7.7080 (1.9); 7.6880 (3.2); 7.6819 (3.0); 7.6670 (3.8); 7.5800 (2.0); 7.5607 (1.4); 7.4808
(3.2); 7.4062 (2.3); 7.3856 (3.4); 7.3121 (1.9); 7.2907 (1.3); 4.1584 (0.9); 4.1430 (0.9); 4.1212 (1.9);
4.1056 (1.8); 4.0841 (0.9); 4.0682 (0.9); 3.8589 (16.0); 3.3250 (70.8); 2.8906 (14.6); 2.7481 (0.4);
2.7313 (12.6); 2.6754 (0.5); 2.6708 (0.6); 2.6663 (0.5); 2.5240 (2.2); 2.5106 (41.5); 2.5063 (81.5);
2.5018 (107.2); 2.4973 (80.2); 2.4930 (40.7); 2.4681 (8.8); 2.3330 (0.5); 2.3286 (0.7); 2.3242 (0.6);
1.2398 (0.9)
I-300: ¹H-NMR(400.1 MHz, CDCl3):
δ = 8.2364 (16.0); 7.8001 (1.4); 7.7863 (2.4); 7.7722 (1.4); 7.6331 (1.8); 7.6158 (3.4); 7.5983 (2.2);
7.5842 (1.9); 7.5640 (3.7); 7.5464 (2.3); 7.4767 (7.2); 7.4554 (11.5); 7.3886 (11.3); 7.3673 (7.0);
7.2617 (3.0); 4.2208 (2.8); 4.2055 (2.8); 4.1858 (6.0); 4.1705 (5.9); 4.1507 (3.1); 4.1354 (3.0); 1.6068
(1.6); 1.2597 (0.9); −0.0002 (2.3)
I-301: ¹H-NMR(400.1 MHz, d₆-DMSO):
δ = 9.2264 (0.8); 9.2110 (1.7); 9.1954 (0.8); 7.9612 (2.4); 7.6802 (0.7); 7.6605 (1.9); 7.6408 (1.5);
7.6049 (2.0); 7.5857 (1.1); 7.4689 (2.6); 7.4489 (1.6); 7.4290 (1.3); 7.2999 (2.1); 7.2799 (2.4); 7.0966
(0.4); 7.0847 (1.3); 7.0691 (3.4); 6.9152 (1.4); 6.8958 (1.4); 4.1172 (0.7); 4.1026 (0.7); 4.0794 (1.5);
4.0638 (1.5); 4.0407 (0.8); 4.0254 (0.8); 3.3117 (53.5); 2.8991 (16.0); 2.8142 (6.8); 2.8014 (7.0);
2.7402 (14.4); 2.5136 (9.2); 2.5092 (12.8); 2.5049 (9.9); 2.4036 (7.1); 2.2302 (9.7)
I-302: ¹H-NMR(400.0 MHz, d₆-DMSO):
δ = 9.1239 (1.2); 9.1040 (1.2); 7.7915 (6.0); 7.7249 (0.6); 7.7052 (1.6); 7.6858 (1.4); 7.6465 (1.8);
7.6259 (3.0); 7.6241 (3.0); 7.5693 (1.3); 7.5481 (1.0); 7.4475 (1.9); 7.4429 (0.9); 7.4336 (2.2); 7.4261
(2.4); 7.4172 (1.0); 7.4121 (2.1); 7.1251 (2.4); 7.1200 (0.8); 7.1083 (0.9); 7.1029 (4.5); 7.0858 (0.7);
7.0806 (2.2); 5.1499 (0.8); 5.1316 (1.2); 5.1134 (0.8); 3.3534 (16.9); 3.3485 (18.8); 3.3447 (19.2);
2.8911 (2.1); 2.7324 (1.9); 2.6073 (16.0); 2.5131 (6.5); 2.5087 (13.8); 2.5042 (18.6); 2.4997 (13.5);
2.4952 (6.5); 1.4371 (6.4); 1.4196 (6.3); −0.0002 (0.4)
I-303: ¹H-NMR(300.2 MHz, CDCl3):
δ = 7.5862 (11.0); 7.5599 (11.7); 7.4913 (6.9); 7.4160 (5.2); 7.3923 (16.3); 7.3873 (16.2); 7.3585
(1.3); 7.2974 (6.3); 7.1929 (0.5); 7.1685 (0.5); 6.6486 (2.1); 6.6303 (3.4); 6.0629 (1.8); 6.0535 (1.7);
6.0392 (1.9); 6.0303 (1.4); 5.9070 (1.8); 5.8978 (1.7); 5.8835 (1.9); 5.8741 (1.3); 4.2674 (0.8); 4.2577
(0.8); 4.2455 (0.9); 4.2354 (0.8); 4.2183 (1.2); 4.2084 (1.1); 4.1958 (1.2); 4.1862 (1.1); 4.1758 (1.0);
4.1659 (0.9); 4.1538 (1.0); 4.1438 (0.8); 4.1267 (1.2); 4.1168 (1.1); 4.1045 (1.1); 4.0949 (0.8); 3.9308
(0.9); 3.9117 (1.3); 3.8874 (1.2); 3.8594 (1.8); 3.8396 (2.3); 3.8167 (1.5); 3.7913 (1.0); 3.7671 (0.5);
3.1037 (0.4); 3.0812 (0.6); 3.0600 (0.3); 2.8435 (0.4); 2.8179 (1.0); 2.7996 (1.7); 2.7925 (1.8); 2.7753
(4.2); 2.7517 (5.8); 2.7274 (4.2); 2.7091 (1.7); 2.6842 (0.8); 2.0314 (0.5); 1.6537 (1.3); 1.3836 (0.5);
1.3266 (8.1); 1.3017 (16.0); 1.2769 (7.3); 0.0345 (5.9)
I-304: ¹H-NMR(300.2 MHz, CDCl3):
δ = 8.0363 (1.6); 7.6740 (2.1); 7.6708 (2.1); 7.6684 (2.1); 7.5589 (0.5); 7.5352 (1.1); 7.5153 (0.7);
7.4966 (2.1); 7.4684 (2.9); 7.4380 (0.5); 7.4137 (1.1); 7.4111 (1.1); 7.3901 (0.9); 7.3608 (1.5); 7.3458
(1.6); 7.3391 (2.1); 7.3177 (1.2); 7.3110 (1.4); 7.2985 (15.2); 7.0977 (1.2); 6.9150 (2.4); 6.7324 (1.2);
6.4557 (0.5); 6.4345 (0.9); 6.4132 (0.5); 4.4928 (1.1); 4.4711 (1.0); 4.4454 (2.3); 4.4239 (2.2); 4.3982
(1.2); 4.3766 (1.1); 2.9890 (13.3); 2.9119 (11.8); 2.6448 (0.6); 2.6287 (16.0); 2.3049 (15.8); 1.6140
(3.5); 0.1064 (1.0); 0.0474 (0.6); 0.0366 (14.6); 0.0257 (0.4)
I-305: ¹H-NMR(300.2 MHz, CDCl3):
δ = 8.2815 (0.7); 8.2781 (0.8); 8.2745 (0.9); 8.2712 (0.7); 8.2544 (0.8); 8.2509 (0.9); 8.2473 (1.0);
8.2440 (0.8); 8.1512 (4.3); 8.1399 (2.1); 8.1326 (1.0); 7.9248 (0.3); 7.9044 (0.6); 7.8860 (0.3); 7.7487
(0.9); 7.7215 (2.1); 7.6943 (1.3); 7.6730 (1.7); 7.6345 (1.1); 7.6310 (1.1); 7.6268 (1.1); 7.6235 (0.9);
7.6072 (0.7); 7.6037 (0.6); 7.5995 (0.7); 7.5962 (0.5); 7.5246 (0.9); 7.4964 (2.7); 7.4711 (1.5); 7.4655
(1.4); 7.4427 (0.5); 7.4372 (0.5); 7.3038 (11.2); 5.3429 (0.4); 4.5082 (0.8); 4.4876 (0.8); 4.4598 (1.6);
4.4393 (1.6); 4.4114 (0.8); 4.3910 (0.8); 2.7765 (12.3); 1.6085 (16.0); 1.3010 (0.4); 1.2950 (0.4);
0.1111 (0.4); 0.0518 (0.3); 0.0410 (9.8)
I-306: ¹H-NMR(300.2 MHz, CDCl3):
δ = 8.9745 (2.9); 8.9671 (2.9); 8.3872 (7.9); 8.2036 (2.4); 8.1986 (2.5); 8.1610 (2.5); 8.1333 (2.3);
7.8510 (1.5); 7.8240 (1.9); 7.7988 (1.0); 7.7941 (0.9); 7.7757 (1.5); 7.7708 (1.8); 7.7659 (0.9); 7.7476
(1.2); 7.7428 (1.0); 7.6426 (4.5); 7.6394 (4.1); 7.6256 (4.1); 7.6117 (2.2); 7.5984 (0.4); 7.5882 (0.9);
7.5848 (0.8); 7.5220 (2.2); 7.4551 (0.9); 7.4468 (1.0); 7.4372 (1.3); 7.4306 (1.1); 7.4249 (0.8); 7.4164
(0.6); 7.3041 (14.2); 5.3419 (5.4); 4.9718 (4.5); 4.9519 (4.5); 1.6342 (16.0); 0.1126 (0.3); 0.0529
(0.5); 0.0421 (13.1); 0.0312 (0.5)
I-307: ¹H-NMR(499.9 MHz, CDCl3):
δ = 8.8520 (6.0); 7.9013 (0.5); 7.8898 (0.9); 7.8784 (0.5); 7.6495 (0.4); 7.6337 (1.6); 7.6206 (4.1);
7.6093 (0.4); 7.6077 (0.4); 7.4977 (2.1); 7.4833 (2.7); 7.4661 (3.8); 7.4371 (0.8); 7.4322 (1.4); 7.4279
(0.9); 7.4257 (0.6); 7.4233 (0.6); 7.4192 (1.0); 7.4147 (0.6); 7.3879 (3.6); 7.3709 (2.6); 7.2627 (2.3);
5.2967 (2.5); 4.2296 (0.9); 4.2174 (0.9); 4.2011 (2.0); 4.1890 (1.9); 4.1726 (1.0); 4.1605 (0.9); 4.0683
(16.0); 3.9452 (0.3); 2.3750 (0.5); 2.3619 (15.1); 1.5878 (0.9); −0.0002 (2.2)
I-308: ¹H-NMR(400.1 MHz, d₆-DMSO):
δ = 9.1918 (1.3); 9.1765 (2.7); 9.1611 (1.3); 7.9612 (1.2); 7.6768 (1.1); 7.6570 (3.2); 7.6372 (2.5);
7.6026 (3.2); 7.5828 (1.7); 7.4505 (4.3); 7.4332 (2.6); 7.4132 (2.0); 7.2901 (3.5); 7.2702 (3.9); 7.0624
(4.4); 6.9041 (2.3); 6.8837 (2.1); 5.7996 (4.1); 5.7854 (4.2); 4.5715 (1.5); 4.5522 (2.5); 4.5306 (2.1);
4.4664 (0.4); 4.4406 (1.4); 4.4259 (1.2); 4.4158 (0.7); 4.1313 (2.6); 4.1222 (2.6); 4.1057 (2.8); 4.0984
(3.2); 4.0853 (1.4); 4.0614 (2.4); 4.0460 (2.3); 4.0229 (1.3); 4.0077 (1.2); 3.3113 (79.2); 2.8990 (7.6);
2.7399 (6.8); 2.5134 (15.7); 2.5090 (21.6); 2.5047 (16.1); 2.4032 (11.6); 2.2479 (0.4); 2.2254 (16.0)
I-309: ¹H-NMR(400.2 MHz, CDCl3):
δ = 8.2884 (16.0); 7.6225 (2.9); 7.6066 (11.9); 7.5882 (4.7); 7.5685 (1.4); 7.3534 (5.8); 7.3226 (3.4);
7.3016 (13.7); 7.2892 (14.6); 7.2629 (15.1); 7.2230 (3.1); 7.2103 (2.3); 7.2053 (3.3); 6.6469 (3.2);
6.5059 (6.5); 6.3648 (3.2); 3.8571 (2.8); 3.8412 (6.7); 3.8257 (6.7); 3.8095 (2.9); 3.0235 (4.5); 3.0069
(8.3); 2.9902 (4.1); 1.6023 (2.4); 1.2532 (1.6); −0.0001 (10.1); −0.0082 (0.3)
I-310: ¹H-NMR(400.0 MHz, d₆-DMSO):
δ = 9.1069 (1.4); 9.0869 (1.4); 7.9515 (0.4); 7.7863 (5.0); 7.7231 (0.6); 7.7033 (1.7); 7.6834 (1.4);
7.6510 (4.0); 7.6304 (1.1); 7.5786 (1.4); 7.5587 (1.0); 7.2181 (1.0); 7.1977 (2.3); 7.1775 (1.4); 6.9698
(3.8); 6.9525 (1.7); 6.7936 (1.3); 6.7761 (1.2); 6.7702 (1.2); 5.1281 (0.8); 5.1094 (1.2); 5.0911 (0.8);
3.6567 (16.0); 3.3556 (34.1); 3.3510 (34.1); 3.3477 (32.7); 2.8901 (2.1); 2.7317 (2.0); 2.6061 (13.6);
2.5068 (15.0); 2.5031 (20.0); 2.4990 (15.8); 1.4343 (5.7); 1.4169 (5.7)
I-311: ¹H-NMR(300.2 MHz, CDCl3):
δ = 7.3533 (2.8); 7.3462 (2.9); 7.2986 (11.0); 7.2419 (2.3); 7.2145 (2.8); 7.1351 (0.5); 7.1077 (2.3);
7.1017 (1.6); 7.0884 (3.6); 7.0810 (1.5); 7.0732 (1.5); 7.0538 (0.4); 6.9914 (1.8); 6.9842 (1.7); 6.9641
(1.4); 6.9569 (1.4); 6.8377 (0.7); 6.8243 (0.7); 6.8164 (0.9); 6.8072 (1.1); 6.7912 (0.6); 6.7840 (0.6);
6.2222 (0.4); 6.2025 (0.7); 6.1838 (0.4); 3.8711 (1.0); 3.8499 (2.8); 3.8280 (2.8); 3.8066 (1.2); 3.1276
(2.0); 3.1054 (3.5); 3.0836 (1.8); 2.6154 (16.0); 2.3523 (15.9); 2.2021 (0.4); 2.1078 (0.5); 2.0967
(0.6); 2.0795 (1.0); 2.0622 (0.6); 2.0511 (0.6); 2.0422 (1.1); 1.6062 (2.5); 1.0613 (0.7); 1.0461 (1.9);
1.0392 (2.1); 1.0332 (1.1); 1.0246 (1.2); 1.0174 (2.1); 1.0107 (1.9); 0.9963 (1.0); 0.8123 (1.0); 0.7974
(2.2); 0.7911 (2.2); 0.7804 (2.0); 0.7748 (2.4); 0.7583 (0.8); 0.1072 (1.0); 0.0482 (0.4); 0.0374 (12.4);
0.0265 (0.5)
I-312: ¹H-NMR(400.0 MHz, CD3CN):
δ = 7.7417 (1.6); 7.7069 (6.6); 7.7047 (6.6); 7.6964 (16.0); 7.6762 (4.0); 7.6564 (3.6); 7.6375 (4.5);
7.6182 (1.8); 7.5264 (5.1); 7.4719 (4.4); 7.4506 (9.1); 7.4273 (2.4); 7.3808 (3.8); 7.3766 (3.6); 7.3596
(2.4); 7.3554 (2.3); 4.3448 (2.7); 4.3285 (2.7); 4.3112 (5.6); 4.2948 (5.5); 4.2775 (2.8); 4.2611 (2.7);
2.2665 (0.8); 2.2541 (1.6); 2.2457 (1.9); 2.2334 (3.0); 2.2213 (1.9); 2.2130 (1.8); 2.2006 (0.9); 2.1302
(47.6); 2.1130 (1.1); 2.1067 (0.9); 2.1005 (0.6); 1.9635 (4.2); 1.9573 (9.7); 1.9516 (51.2); 1.9455
(94.0); 1.9393 (126.6); 1.9331 (87.6); 1.9270 (45.1); 1.7740 (0.6); 1.7677 (0.7); 1.7616 (0.5); 1.1093
(1.3); 1.1039 (1.3); 1.0967 (3.6); 1.0904 (6.0); 1.0826 (3.3); 1.0759 (3.8); 1.0700 (5.3); 1.0621 (2.9);
1.0572 (1.5); 1.0488 (1.1); 1.0379 (2.9); 1.0301 (6.6); 1.0249 (5.6); 1.0179 (6.3); 1.0116 (4.7); 0.9991
(1.3); −0.0002 (14.0)
I-313: ¹H-NMR(300.2 MHz, CDCl3):
δ = 8.2708 (0.8); 8.2671 (1.0); 8.2638 (1.0); 8.2605 (0.7); 8.2440 (0.9); 8.2401 (1.1); 8.2369 (1.1);
8.2335 (0.8); 8.1779 (4.2); 8.1423 (1.3); 8.1352 (2.1); 8.1280 (1.1); 7.9416 (0.7); 7.9226 (0.4); 7.7338
(0.9); 7.7066 (2.1); 7.6797 (1.5); 7.6422 (1.3); 7.6384 (1.4); 7.6346 (1.3); 7.6312 (1.0); 7.6150 (0.6);
7.6112 (0.6); 7.6074 (0.7); 7.6039 (0.5); 7.3856 (1.6); 7.3589 (1.8); 7.3040 (10.7); 7.0845 (1.9);
7.0149 (1.1); 6.9883 (0.9); 5.3431 (1.8); 4.3221 (0.9); 4.3025 (0.8); 4.2736 (1.8); 4.2539 (1.7); 4.2251
(0.9); 4.2053 (0.9); 2.7774 (13.0); 2.5218 (5.4); 2.3275 (7.6); 1.6100 (16.0); 0.1120 (0.3); 0.0524
(0.4); 0.0417 (9.2); 0.0308 (0.3)
I-314: ¹H-NMR(300.2 MHz, CDCl3):
δ = 8.3173 (15.8); 8.0135 (1.2); 7.9938 (2.2); 7.9750 (1.3); 7.6882 (7.3); 7.6710 (9.2); 7.6460 (0.4);
7.5472 (4.9); 7.5161 (0.6); 7.5038 (2.2); 7.4941 (2.0); 7.4879 (2.8); 7.4814 (2.5); 7.4732 (1.8); 7.4652
(1.3); 7.4327 (4.9); 7.4057 (5.4); 7.3039 (13.7); 7.0301 (5.6); 6.9468 (3.1); 6.9198 (2.8); 4.3067 (2.3);
4.2867 (2.3); 4.2580 (4.9); 4.2381 (4.6); 4.2093 (2.5); 4.1894 (2.4); 3.9643 (0.5); 2.5430 (16.0);
2.4086 (0.6); 2.3697 (1.0); 2.3518 (1.8); 2.3362 (1.9); 2.3210 (1.9); 2.3023 (1.2); 1.8630 (0.7); 1.8439
(1.3); 1.8328 (1.1); 1.8279 (1.2); 1.8218 (1.4); 1.8174 (1.4); 1.8143 (1.4); 1.8064 (1.0); 1.7983 (1.3);
1.7955 (1.3); 1.7764 (0.9); 1.6142 (1.7); 1.4666 (1.6); 1.4476 (3.0); 1.4344 (1.8); 1.4288 (1.8); 1.4161
(2.8); 1.3970 (1.5); 1.3773 (0.4); 1.3515 (0.5); 1.3282 (0.8); 1.2993 (2.8); 1.2214 (1.3); 1.2012 (2.2);
1.1918 (1.5); 1.1884 (1.4); 1.1820 (1.4); 1.1717 (2.0); 1.1521 (1.0); 0.9242 (0.4); 0.9000 (0.4); 0.1149
(1.4); 0.0539 (0.6); 0.0432 (13.5); 0.0323 (0.5)
I-315: ¹H-NMR(400.1 MHz, CDCl3):
δ = 8.2186 (6.5); 7.7852 (0.6); 7.7711 (1.1); 7.7570 (0.6); 7.6279 (3.3); 7.6003 (1.1); 7.5749 (1.6);
7.5572 (1.0); 7.4706 (1.7); 7.4494 (3.9); 7.4208 (2.4); 7.4172 (2.3); 7.4064 (1.3); 7.4004 (1.3); 7.3959
(1.2); 7.3865 (1.8); 7.3661 (0.8); 7.2657 (1.4); 4.4427 (1.2); 4.4271 (1.2); 4.4072 (2.5); 4.3916 (2.4);
4.3717 (1.3); 4.3561 (1.2); 1.9938 (16.0); 1.6170 (0.5); 1.2598 (0.6); −0.0002 (1.0)
I-316: ¹H-NMR(400.1 MHz, d₆-DMSO):
δ = 9.1925 (1.3); 9.1769 (2.6); 9.1616 (1.3); 8.7769 (5.7); 8.7622 (5.9); 8.4613 (8.3); 8.1081 (6.1);
8.0932 (5.8); 7.9591 (2.9); 7.7898 (1.0); 7.7704 (2.8); 7.7508 (2.8); 7.7282 (3.7); 7.7066 (5.5); 7.6428
(2.6); 7.6228 (2.0); 7.3481 (3.3); 7.3281 (3.6); 7.0857 (4.4); 6.9282 (2.4); 6.9087 (2.2); 4.1837 (1.3);
4.1685 (1.3); 4.1468 (2.7); 4.1313 (2.6); 4.1097 (1.4); 4.0941 (1.2); 3.3186 (40.9); 2.8965 (16.0);
2.7374 (14.8); 2.6764 (0.7); 2.5111 (86.0); 2.5074 (106.8); 2.4412 (11.7); 2.3342 (0.7); 2.2197 (15.6)
I-317: ¹H-NMR(300.2 MHz, d₆-DMSO):
δ = 7.5163 (0.3); 7.3064 (0.3); 7.0974 (0.3); 5.7792 (2.0); 3.9609 (2.7); 3.3470 (16.0); 2.5338 (1.3);
2.5279 (2.7); 2.5218 (3.7); 2.5158 (2.6); 2.5099 (1.2); 2.4408 (2.6); 2.4301 (1.0); 2.2524 (1.2);
0.0200 (2.1)
I-318: ¹H-NMR(400.0 MHz, d₆-DMSO):
δ = 9.0374 (1.1); 9.0163 (1.1); 8.1747 (5.2); 7.7497 (0.4); 7.7308 (1.2); 7.7102 (1.2); 7.6834 (3.8);
7.6651 (0.8); 7.6319 (1.2); 7.6127 (0.8); 7.2428 (1.1); 7.2214 (1.3); 6.6695 (4.4); 6.6509 (1.3); 6.6443
(0.8); 5.1224 (0.6); 5.1050 (0.6); 3.6947 (16.0); 3.3815 (19.9); 3.3749 (23.8); 3.3710 (22.9); 3.3661
(26.3); 2.7448 (0.5); 2.7265 (1.1); 2.7105 (1.0); 2.6949 (0.5); 2.5143 (4.4); 2.5099 (9.3); 2.5054
(12.4); 2.5009 (8.9); 2.4964 (4.3); 1.9820 (0.4); 1.9695 (0.5); 1.9605 (0.5); 1.9466 (0.4); 1.8780 (0.3);
1.8661 (0.3); 1.8514 (0.4); 1.8324 (0.4); 1.8124 (0.4); 1.7924 (0.5); 1.7866 (0.4); 1.7610 (0.7); 1.7451
(0.8); −0.0002 (0.4)
I-319: ¹H-NMR(400.1 MHz, d₆-DMSO):
δ = 9.1820 (1.0); 9.1673 (1.8); 9.1521 (0.9); 8.8556 (5.6); 8.7191 (3.1); 8.7067 (3.2); 8.2433 (6.6);
8.1088 (1.5); 7.9594 (2.6); 7.7574 (3.8); 7.7359 (2.9); 7.7235 (3.4); 7.7031 (1.4); 7.6842 (0.8); 7.6632
(0.7); 7.6447 (1.6); 7.6285 (1.3); 7.6068 (0.4); 7.5464 (0.7); 7.5422 (0.6); 7.5250 (3.8); 7.5217 (4.0);
7.5128 (4.9); 7.5028 (2.3); 7.4922 (1.3); 7.4829 (0.9); 7.4537 (1.2); 7.3186 (2.4); 7.2950 (0.6); 7.1837
(1.2); 6.0935 (0.5); 6.0828 (0.7); 6.0686 (0.5); 5.9780 (0.5); 5.9677 (0.7); 5.9536 (0.5); 3.9723 (0.4);
3.9565 (0.7); 3.9400 (0.5); 3.9198 (0.7); 3.8990 (1.0); 3.8841 (0.7); 3.8721 (0.5); 3.8633 (0.6); 3.8503
(0.7); 3.8396 (0.5); 3.8276 (0.4); 3.3271 (461.8); 3.2757 (0.4); 2.8981 (16.0); 2.7390 (14.6); 2.5129
(14.0); 2.5087 (18.4); 2.5046 (13.6)
I-320: ¹H-NMR(400.0 MHz, d₆-DMSO):
δ = 9.3444 (1.8); 9.3255 (1.8); 8.1952 (8.4); 8.1921 (4.0); 8.1911 (4.0); 7.7539 (0.8); 7.7344 (2.4);
7.7136 (2.3); 7.6881 (7.6); 7.6678 (2.5); 7.6420 (16.0); 7.6172 (2.3); 5.2152 (1.2); 5.1972 (1.8);
5.1792 (1.2); 3.4040 (35.2); 3.3907 (39.7); 3.3806 (47.6); 2.8945 (1.8); 2.7361 (1.6); 2.5318 (0.4);
2.5186 (8.4); 2.5141 (17.7); 2.5096 (23.8); 2.5051 (17.2); 2.5006 (8.3); 1.4859 (9.2); 1.4683 (9.1)
I-321: ¹H-NMR(600.4 MHz, d₆-DMSO):
δ = 9.1468 (1.4); 9.1364 (2.8); 9.1261 (1.4); 8.0390 (16.0); 7.7494 (1.4); 7.7363 (3.6); 7.7230 (2.9);
7.6991 (3.6); 7.6861 (1.9); 7.6505 (4.4); 7.5921 (2.5); 7.5782 (2.0); 7.5543 (5.5); 7.5419 (6.5); 7.4644
(1.1); 7.4521 (3.3); 7.4399 (2.4); 7.4043 (4.6); 7.3915 (6.3); 7.3791 (2.4); 5.7520 (7.4); 4.1340 (1.4);
4.1235 (1.5); 4.1100 (3.4); 4.0995 (3.4); 4.0860 (1.6); 4.0755 (1.5); 3.3064 (283.7); 2.6152 (1.8);
2.6122 (2.4); 2.6091 (1.8); 2.6061 (0.8); 2.5211 (6.3); 2.5180 (8.8); 2.5148 (11.5); 2.5062 (154.6);
2.5032 (306.4); 2.5002 (411.0); 2.4971 (298.7); 2.4941 (141.4); 2.3902 (0.9); 2.3871 (1.8); 2.3841
(2.4); 2.3811 (1.7); 2.3783 (0.8); 0.0053 (0.8); −0.0001 (18.0); −0.0056 (0.6)
I-322: ¹H-NMR(400.0 MHz, d₆-DMSO):
δ = 9.2125 (1.6); 9.1966 (3.4); 9.1811 (1.6); 8.0193 (16.0); 7.7647 (1.4); 7.7451 (10.2); 7.7256 (4.1);
7.7097 (5.0); 7.6900 (2.0); 7.6272 (5.6); 7.5705 (6.2); 7.5630 (3.6); 7.5492 (7.5); 7.2415 (3.3); 7.2367
(3.3); 7.2204 (3.0); 7.2155 (3.0); 4.3037 (1.7); 4.2877 (1.7); 4.2691 (3.7); 4.2533 (3.6); 4.2345 (1.9);
4.2187 (1.8); 3.3453 (160.3); 3.3389 (155.7); 3.3371 (144.2); 2.6769 (0.4); 2.6724 (0.6); 2.6682 (0.5);
2.5429 (72.5); 2.5256 (2.2); 2.5122 (42.4); 2.5081 (85.0); 2.5037 (112.0); 2.4993 (81.0); 2.3352 (0.5);
2.3307 (0.6); 2.1967 (0.7); 1.2340 (0.4); −0.0002 (2.2)
I-323: ¹H-NMR(400.2 MHz, d₆-DMSO):
δ = 8.6720 (1.4); 8.6574 (2.8); 8.6429 (1.4); 8.3164 (0.3); 8.0392 (16.0); 7.7500 (1.2); 7.7306 (3.7);
7.7109 (3.9); 7.6985 (4.6); 7.6786 (1.6); 7.6249 (5.0); 7.5450 (2.8); 7.5255 (2.2); 7.2797 (6.6); 7.2586
(10.9); 7.1976 (11.7); 7.1765 (6.9); 3.9028 (2.7); 3.5197 (0.4); 3.5037 (0.8); 3.4868 (2.2); 3.4706
(4.4); 3.4549 (4.1); 3.4368 (2.3); 3.4186 (0.8); 3.4034 (0.6); 3.3299 (155.0); 3.0627 (1.1); 3.0450
(2.2); 3.0273 (2.2); 3.0098 (1.1); 2.9849 (0.3); 2.6760 (1.0); 2.6715 (1.3); 2.6670 (1.0); 2.5246 (5.7);
2.5070 (178.6); 2.5026 (220.8); 2.4981 (159.0); 2.3337 (1.0); 2.3294 (1.3); 2.3250 (1.0); 1.2985 (0.3);
1.2672 (0.4); 1.2585 (0.4); 1.2325 (13.6); 1.2150 (13.0); −0.0002 (0.8)
I-324: ¹H-NMR(499.9 MHz, d₆-DMSO):
δ = 9.1899 (0.7); 9.1774 (1.4); 9.1649 (0.7); 8.8468 (4.4); 8.7087 (2.5); 8.6989 (2.7); 8.1538 (5.5);
8.0164 (0.4); 7.9540 (2.5); 7.7877 (0.6); 7.7720 (1.6); 7.7563 (1.4); 7.7413 (2.3); 7.7313 (1.9); 7.7153
(3.4); 7.7054 (2.6); 7.6672 (1.3); 7.6517 (1.1); 7.3252 (1.9); 7.3092 (2.2); 7.0717 (2.3); 6.9066 (1.2);
6.8906 (1.2); 4.1625 (0.6); 4.1500 (0.6); 4.1332 (1.4); 4.1207 (1.3); 4.1039 (0.7); 4.0914 (0.7); 3.3184
(11.9); 2.8911 (16.0); 2.7325 (14.3); 2.5058 (3.4); 2.5024 (4.6); 2.4990 (3.4); 2.4273 (6.0); 2.2076
(9.2); −0.0002 (1.8)
I-325: ¹H-NMR(400.0 MHz, d₆-DMSO):
δ = 8.9285 (0.7); 8.9139 (1.4); 8.8992 (0.7); 8.1175 (7.0); 7.7646 (0.5); 7.7441 (1.7); 7.7243 (1.7);
7.7072 (2.2); 7.6912 (3.3); 7.6064 (1.5); 7.5860 (1.1); 7.3348 (2.0); 7.3233 (0.6); 7.3133 (2.1); 6.7648
(1.3); 6.7602 (2.6); 6.7532 (3.4); 6.7486 (3.8); 6.7441 (2.8); 6.7397 (1.1); 5.7551 (16.0); 4.6537 (1.1);
4.6308 (2.6); 4.6079 (1.4); 4.4551 (1.4); 4.4412 (1.4); 4.4320 (1.1); 4.4180 (1.1); 3.7556 (0.6); 3.7397
(0.8); 3.7335 (0.7); 3.7175 (0.7); 3.5908 (0.4); 3.5725 (1.1); 3.5579 (2.3); 3.5430 (2.0); 3.5276 (1.0);
3.3207 (42.7); 2.6752 (0.4); 2.6709 (0.5); 2.6666 (0.4); 2.5063 (63.5); 2.5019 (82.0); 2.4976 (61.0);
2.3332 (0.4); 2.3286 (0.5); 1.9888 (0.6); 1.3559 (1.0); 1.2353 (0.4); 1.1752 (0.4); 0.0079
(0.7); −0.0001 (16.0); −0.0079 (0.7)
I-326: ¹H-NMR(499.9 MHz, CDCl3):
δ = 9.2745 (0.3); 9.2540 (16.0); 7.5865 (0.9); 7.5708 (3.4); 7.5573 (9.5); 7.5515 (6.0); 7.5442 (1.1);
7.5344 (5.8); 7.4798 (4.4); 7.4760 (4.5); 7.4671 (0.4); 7.4411 (4.0); 7.3961 (0.4); 7.3848 (1.6); 7.3797
(3.2); 7.3754 (2.0); 7.3724 (1.1); 7.3705 (1.2); 7.3666 (2.1); 7.3618 (1.2); 7.2604 (24.5); 7.1721 (2.9);
7.1680 (2.8); 7.1551 (2.6); 7.1511 (2.6); 6.3500 (1.0); 6.3375 (1.9); 6.3251 (1.0); 4.4383 (2.2); 4.4254
(2.1); 4.4096 (4.7); 4.3968 (4.5); 4.3809 (2.4); 4.3681 (2.2); 2.0011 (0.5); 1.5542 (18.5); 1.2648 (0.6);
1.2553 (0.7); 0.8818 (0.7); 0.8675 (0.3); 0.0063 (1.0); −0.0002 (25.2); −0.0068 (1.0)
I-327: ¹H-NMR(400.2 MHz, d₆-DMSO):
δ = 9.1371 (1.2); 9.1215 (2.5); 9.1059 (1.2); 7.9737 (13.3); 7.9522 (1.6); 7.6923 (1.5); 7.6885 (1.8);
7.6803 (2.6); 7.6738 (1.9); 7.6706 (1.8); 7.6666 (1.9); 7.6326 (3.2); 7.6276 (5.2); 7.3070 (3.8); 7.2871
(8.2); 7.2816 (3.9); 7.2773 (6.8); 7.2743 (6.6); 7.2659 (0.6); 7.2611 (0.5); 7.0759 (4.3); 6.9332 (2.2);
6.9131 (2.0); 4.1191 (1.2); 4.1034 (1.2); 4.0823 (2.7); 4.0666 (2.6); 4.0454 (1.4); 4.0297 (1.3); 3.3326
(59.6); 2.8920 (11.1); 2.7333 (9.8); 2.5256 (1.0); 2.5122 (19.2); 2.5079 (37.8); 2.5034 (49.0); 2.4989
(35.7); 2.4946 (17.6); 2.4147 (11.2); 2.2418 (16.0); 1.2400 (1.2); −0.0002 (1.4)
I-328: ¹H-NMR(400.0 MHz, d₆-DMSO):
δ = 9.2052 (1.7); 9.1897 (3.6); 9.1741 (1.7); 8.0308 (15.6); 7.7605 (1.4); 7.7411 (4.2); 7.7215 (4.1);
7.7046 (4.9); 7.6850 (2.0); 7.6471 (5.5); 7.5826 (3.3); 7.5630 (2.5); 7.4331 (5.2); 7.4118 (5.9); 7.3688
(5.5); 7.1459 (3.0); 7.1424 (3.0); 7.1251 (2.6); 7.1213 (2.6); 4.1622 (1.7); 4.1465 (1.8); 4.1257 (3.8);
4.1100 (3.6); 4.0891 (1.9); 4.0733 (1.8); 3.3227 (237.7); 3.2863 (0.4); 2.6751 (0.7); 2.6706 (0.9);
2.6665 (0.7); 2.5410 (58.8); 2.5061 (100.3); 2.5016 (133.1); 2.4972 (103.8); 2.4562 (16.0); 2.3327
(0.6); 2.3284 (0.8); 2.3239 (0.6); −0.0002 (0.4)
I-329: ¹H-NMR(400.2 MHz, d₆-DMSO):
δ = 8.7603 (6.6); 8.3162 (0.8); 8.0247 (16.0); 7.7557 (1.3); 7.7363 (4.0); 7.7168 (4.2); 7.7042 (5.0);
7.6847 (1.8); 7.5976 (5.4); 7.5533 (3.1); 7.5339 (2.4); 7.2748 (8.5); 7.2539 (10.6); 7.2393 (0.8);
7.1053 (11.8); 7.0844 (9.2); 3.9025 (1.1); 3.3263 (259.7); 2.9016 (14.2); 2.6753 (2.4); 2.6710 (3.1);
2.6665 (2.2); 2.5242 (11.5); 2.5105 (218.6); 2.5065 (413.6); 2.5020 (518.4); 2.4975 (370.7); 2.4934
(181.2); 2.3333 (2.2); 2.3288 (3.0); 2.3244 (2.2); 1.2356 (0.4); 0.9055 (2.2); 0.8878 (7.7); 0.8767
(3.3); 0.8492 (0.4); 0.8377 (0.6); 0.8274 (0.6); 0.7880 (3.2); 0.7770 (7.3); 0.7594 (2.1); −0.0002 (2.8)
I-330: ¹H-NMR(400.1 MHz, CDCl3):
δ = 7.6095 (0.8); 7.5904 (0.8); 7.5374 (0.4); 7.5181 (1.4); 7.4983 (3.0); 7.4777 (3.1); 7.4574 (1.1);
7.4528 (1.5); 7.4478 (0.8); 7.4341 (0.8); 7.2965 (2.8); 7.2764 (3.9); 7.2596 (8.9); 7.1936 (0.4); 7.1754
(3.4); 7.1556 (2.4); 5.2825 (0.8); 5.2645 (1.2); 5.2465 (0.8); 3.8111 (0.4); 3.8000 (0.5); 3.7933 (0.6);
3.7881 (0.8); 3.7822 (0.7); 3.7773 (0.8); 3.7702 (0.8); 3.7593 (0.6); 3.7108 (0.6); 3.6996 (0.8); 3.6935
(0.8); 3.6876 (0.6); 3.6824 (0.8); 3.6764 (0.6); 3.6707 (0.5); 3.6593 (0.4); 3.2424 (1.1); 3.2332 (16.0);
3.0592 (0.4); 3.0532 (0.4); 3.0417 (0.4); 3.0353 (0.9); 3.0244 (1.0); 3.0183 (1.1); 3.0100 (1.2); 3.0078
(1.1); 2.9992 (1.1); 2.9925 (0.9); 2.9813 (0.8); 2.9759 (0.4); 2.3580 (0.8); 2.3407 (10.8); 1.6010 (6.6);
1.5837 (6.5); 1.5593 (11.3); −0.0002 (4.9)
I-331: ¹H-NMR(400.0 MHz, d₆-DMSO):
δ = 9.1462 (2.0); 9.1253 (2.3); 9.1024 (0.3); 8.2182 (10.8); 7.7483 (0.9); 7.7290 (2.7); 7.7094 (2.7);
7.6884 (6.5); 7.6676 (1.6); 7.6270 (2.3); 7.6078 (1.4); 7.4824 (3.9); 7.3553 (1.5); 7.3517 (1.5); 7.3351
(2.8); 7.3317 (2.8); 7.3140 (0.5); 7.2787 (4.0); 7.2587 (2.5); 7.2258 (0.4); 7.1538 (0.3); 5.4774 (0.6);
5.4576 (1.9); 5.4376 (1.9); 5.4178 (0.6); 4.0383 (0.5); 4.0205 (0.5); 3.3207 (41.0); 3.0034 (0.4);
2.9957 (0.5); 2.9820 (0.5); 2.9737 (0.6); 2.9631 (1.0); 2.9553 (1.2); 2.9413 (1.1); 2.9333 (1.1); 2.9113
(0.7); 2.8903 (1.5); 2.8698 (1.1); 2.8498 (0.7); 2.8287 (0.4); 2.6754 (0.4); 2.6707 (0.6); 2.6663 (0.4);
2.5062 (74.4); 2.5018 (96.6); 2.4974 (72.8); 2.4776 (1.9); 2.4687 (1.2); 2.4576 (0.7); 2.4494 (0.5);
2.3330 (0.4); 2.3287 (0.6); 2.3243 (0.4); 1.9888 (2.1); 1.9584 (0.4); 1.9367 (1.3); 1.9270 (0.5); 1.9158
(1.4); 1.9051 (1.2); 1.8941 (0.7); 1.8844 (1.2); 1.8625 (0.5); 1.3978 (16.0); 1.1929 (0.6); 1.1751 (1.1);
1.1572 (0.5); 0.0080 (0.5); −0.0002 (12.4)
I-332: ¹H-NMR(400.0 MHz, d₆-DMSO):
δ = 9.0377 (1.4); 9.0177 (1.4); 8.1195 (7.3); 7.7179 (0.5); 7.6985 (1.8); 7.6791 (2.0); 7.6679 (2.3);
7.6527 (2.4); 7.6331 (2.1); 7.6100 (2.4); 7.5607 (1.4); 7.5413 (1.0); 7.3851 (2.1); 7.3645 (2.4); 7.3110
(4.5); 7.1229 (1.0); 7.1050 (1.8); 7.0848 (1.0); 6.8868 (1.2); 6.8688 (2.0); 6.8493 (1.0); 5.4415 (0.8);
5.4237 (1.2); 5.4053 (0.8); 3.7164 (16.0); 3.3816 (40.4); 3.3772 (58.2); 3.3751 (58.9); 3.3725 (57.4);
2.8901 (0.4); 2.7321 (0.3); 2.5132 (6.4); 2.5088 (13.5); 2.5043 (18.2); 2.4997 (13.2); 2.4953 (6.4);
1.6142 (5.9); 1.5972 (5.8)
I-333: ¹H-NMR(300.2 MHz, CDCl3):
δ = 8.4518 (8.3); 7.6191 (0.6); 7.5932 (2.3); 7.5710 (8.5); 7.5439 (4.8); 7.5224 (3.2); 7.5163 (3.2);
7.4671 (3.1); 7.4234 (1.3); 7.4156 (2.2); 7.4084 (1.2); 7.3925 (1.4); 7.2985 (19.0); 7.2108 (2.1);
7.2041 (2.0); 7.1825 (1.8); 7.1758 (1.7); 6.5053 (0.8); 6.4836 (1.5); 6.4628 (0.8); 4.5058 (1.6); 4.4843
(1.6); 4.4577 (3.5); 4.4362 (3.4); 4.4096 (1.8); 4.3881 (1.7); 2.0808 (0.4); 2.0518 (0.4); 2.0349 (0.8);
2.0235 (0.9); 2.0070 (1.8); 1.9903 (1.0); 1.9791 (1.0); 1.9623 (0.5); 1.6106 (16.0); 1.3726 (0.4);
1.3266 (1.4); 1.3026 (5.0); 1.2993 (4.8); 1.2912 (4.4); 1.2816 (3.6); 1.2750 (3.1); 1.2585 (1.5); 1.2389
(0.4); 1.0669 (1.3); 1.0504 (3.7); 1.0445 (3.0); 1.0340 (2.8); 1.0274 (3.5); 1.0104 (0.9); 0.9399 (0.6);
0.9181 (1.7); 0.8946 (0.8); 0.0469 (0.6); 0.0361 (17.7); 0.0252 (0.7)
I-334: ¹H-NMR(400.0 MHz, d₆-DMSO):
δ = 9.3003 (2.0); 9.2846 (4.1); 9.2691 (2.0); 8.2666 (6.3); 8.2624 (6.7); 8.0294 (16.0); 7.8070 (3.0);
7.8030 (3.2); 7.7860 (3.9); 7.7817 (4.1); 7.7647 (1.5); 7.7451 (4.6); 7.7254 (4.6); 7.7102 (5.6); 7.6907
(2.1); 7.6468 (7.1); 7.6253 (11.6); 7.5525 (3.6); 7.5329 (2.9); 4.2802 (1.8); 4.2641 (1.9); 4.2473 (4.0);
4.2314 (3.9); 4.2139 (2.1); 4.1982 (1.9); 3.4387 (0.3); 3.3988 (0.4); 3.3266 (755.1); 3.2641 (0.6);
2.9944 (1.6); 2.7108 (0.6); 2.6709 (2.0); 2.6665 (1.5); 2.5783 (0.4); 2.5412 (117.0); 2.5060 (221.3);
2.5017 (293.9); 2.4975 (233.2); 2.3671 (0.5); 2.3330 (1.3); 2.3284 (1.8); 2.3243 (1.4); −0.0001 (1.0)
I-335: ¹H-NMR(300.2 MHz, CDCl3):
δ = 8.3238 (0.4); 7.9861 (1.3); 7.6202 (0.4); 7.5955 (1.7); 7.5834 (1.1); 7.5748 (3.7); 7.5527 (0.4);
7.5367 (0.4); 7.4796 (2.2); 7.4721 (7.0); 7.4636 (1.5); 7.4569 (0.8); 7.4492 (0.6); 7.4417 (0.8); 7.3977
(1.8); 7.3712 (2.1); 7.3052 (17.2); 7.1088 (1.9); 7.0903 (0.8); 7.0311 (1.0); 7.0039 (0.9); 5.3447 (1.9);
4.6763 (0.9); 4.6303 (1.9); 4.5837 (1.0); 4.0656 (3.7); 3.8353 (2.5); 3.7644 (16.0); 3.7476 (0.4);
3.7191 (1.5); 2.5302 (5.5); 2.5231 (3.3); 2.4922 (1.2); 2.3709 (9.7); 2.3269 (0.5); 2.0528 (11.0);
1.5969 (16.6); 1.2985 (0.4); 0.1138 (0.7); 0.0549 (0.5); 0.0440 (16.6); 0.0331 (0.6)
I-336: ¹H-NMR(300.2 MHz, CDCl3):
δ = 7.5747 (0.4); 7.5483 (4.1); 7.5273 (5.0); 7.5238 (4.3); 7.5028 (2.5); 7.4966 (2.5); 7.4316 (2.2);
7.3774 (0.9); 7.3681 (1.5); 7.3609 (1.0); 7.3539 (0.6); 7.3468 (1.0); 7.3391 (0.6); 7.2981 (2.0); 7.2026
(1.5); 7.1960 (1.4); 7.1744 (1.3); 7.1678 (1.2); 6.9706 (0.6); 6.9495 (1.2); 6.9284 (0.6); 5.3293 (0.7);
4.4199 (1.0); 4.3985 (0.9); 4.3715 (2.1); 4.3501 (2.0); 4.3231 (1.0); 4.3017 (1.0); 2.7728 (3.0); 2.5541
(16.0); 2.2262 (15.8); 2.0615 (1.0); 1.9642 (0.5); 1.3062 (0.4); 1.2891 (0.5); 1.2825 (0.7); 0.1070
(2.6); 0.0323 (1.8)
I-337: ¹H-NMR(400.2 MHz, d₆-DMSO):
δ = 9.2551 (0.7); 9.2395 (1.4); 9.2239 (0.7); 7.9694 (7.6); 7.9530 (0.8); 7.3266 (2.1); 7.3066 (2.4);
7.2532 (0.6); 7.2489 (0.5); 7.2322 (1.5); 7.2282 (1.4); 7.2113 (1.1); 7.2076 (1.2); 7.1784 (0.9); 7.1747
(1.0); 7.1567 (1.4); 7.1383 (0.6); 7.1351 (0.5); 7.0708 (2.4); 6.9499 (1.3); 6.9376 (1.1); 6.9335 (1.7);
6.9213 (1.2); 6.9178 (1.6); 6.9008 (0.8); 6.8972 (0.7); 4.1183 (0.7); 4.1026 (0.7); 4.0815 (1.6); 4.0656
(1.5); 4.0443 (0.8); 4.0286 (0.7); 3.9032 (16.0); 3.3357 (32.7); 2.8922 (5.0); 2.7342 (4.4); 2.5263
(0.4); 2.5127 (8.8); 2.5084 (17.2); 2.5039 (22.2); 2.4994 (16.0); 2.4950 (7.8); 2.4210 (6.4); 2.2131
(9.2); −0.0002 (0.8)
I-338: ¹H-NMR(300.2 MHz, CDCl3):
δ = 7.6016 (1.4); 7.5817 (5.1); 7.5659 (0.4); 7.5622 (0.4); 7.5517 (2.3); 7.5344 (1.8); 7.5282 (1.8);
7.4798 (1.6); 7.4279 (0.8); 7.4179 (1.1); 7.4107 (0.9); 7.3974 (0.7); 7.3898 (0.4); 7.2994 (15.3);
7.2501 (1.2); 7.2434 (1.1); 7.2218 (1.0); 7.2151 (0.9); 6.4561 (0.4); 6.4349 (0.8); 6.4143 (0.4); 4.4815
(0.9); 4.4601 (0.9); 4.4331 (2.0); 4.4117 (1.9); 4.3847 (1.0); 4.3632 (1.0); 2.4207 (16.0); 2.0810 (0.8);
1.5852 (8.3); 1.2966 (0.6); 0.0497 (0.6); 0.0389 (15.9); 0.0297 (0.5); 0.0281 (0.6)
I-339: ¹H-NMR(300.2 MHz, CDCl3):
δ = 8.6897 (1.1); 7.6824 (1.8); 7.6644 (3.0); 7.6451 (1.8); 7.6102 (0.9); 7.5818 (9.1); 7.5766 (6.1);
7.5644 (14.7); 7.5400 (0.6); 7.5011 (8.5); 7.4722 (16.0); 7.4125 (20.2); 7.3839 (7.8); 7.3599 (0.9);
7.3462 (2.9); 7.3376 (2.8); 7.3322 (4.3); 7.3260 (3.8); 7.3165 (2.9); 7.3077 (2.2); 7.2988 (10.2);
5.0630 (0.9); 5.0557 (0.8); 5.0426 (1.9); 5.0364 (1.6); 5.0198 (3.7); 5.0084 (11.6); 5.0043 (11.9);
4.9893 (12.0); 4.9687 (3.6); 4.6636 (0.5); 4.6553 (0.5); 4.6351 (5.2); 4.6225 (9.9); 4.6157 (8.7);
4.5996 (4.3); 4.1990 (3.6); 4.1852 (1.5); 4.1786 (3.6); 4.1618 (2.6); 4.1511 (7.7); 4.1379 (3.4); 4.1307
(7.5); 4.1144 (1.3); 4.1032 (3.9); 4.0828 (3.8); 2.0757 (9.0); 1.6713 (11.2); 1.3153 (2.6); 1.2915 (6.7);
1.2677 (2.5); 0.9691 (0.4); 0.9152 (0.3); 0.1085 (0.4); 0.0354 (7.9); 0.0245 (0.3)
I-340: ¹H-NMR(400.0 MHz, d₆-DMSO):
δ = 9.3071 (1.2); 9.2871 (1.2); 8.1954 (6.8); 7.9537 (1.1); 7.8053 (2.4); 7.7586 (2.1); 7.7442 (3.7);
7.7384 (3.0); 7.7235 (1.8); 7.7065 (1.9); 7.6871 (0.8); 7.6527 (1.3); 7.6332 (0.8); 7.6107 (2.0); 7.5883
(2.2); 7.5263 (1.4); 7.5221 (1.5); 7.5050 (1.2); 7.5008 (1.3); 7.2754 (2.1); 7.2692 (2.2); 7.1039 (1.5);
7.0976 (1.5); 7.0816 (1.4); 7.0753 (1.4); 5.2881 (0.7); 5.2699 (1.0); 5.2516 (0.7); 3.8490 (16.0);
3.3872 (27.9); 3.3768 (57.7); 2.8912 (7.3); 2.7336 (6.4); 2.5241 (0.4); 2.5156 (6.2); 2.5112 (13.2);
2.5066 (17.7); 2.5021 (12.7); 2.4976 (6.1); 1.5457 (5.0); 1.5283 (5.0)
I-341: ¹H-NMR(300.1 MHz, CDCl3):
δ = 10.5645 (0.6); 7.8033 (6.2); 7.4910 (0.4); 7.4684 (4.0); 7.4462 (1.7); 7.4198 (0.5); 7.3096 (1.9);
7.2834 (2.7); 7.2635 (4.9); 7.1684 (1.5); 7.1424 (1.1); 7.1172 (1.1); 7.1017 (0.7); 7.0946 (1.1); 7.0868
(0.7); 7.0583 (2.1); 6.9646 (3.1); 6.9615 (3.3); 6.8963 (3.2); 6.8931 (3.0); 6.5770 (2.3); 3.7639 (0.9);
3.7499 (1.6); 3.7365 (1.6); 3.7302 (1.4); 3.7238 (1.7); 3.7098 (1.0); 3.5305 (16.0); 2.9568 (1.2);
2.8848 (2.1); 2.8674 (2.0); 2.8473 (1.6); 2.1904 (12.0); 1.2538 (1.6); 0.0708 (0.4); −0.0009 (3.8)
I-342: ¹H-NMR(400.1 MHz, CDCl3):
δ = 8.0106 (2.0); 7.4349 (2.4); 7.4140 (2.8); 7.3876 (3.0); 7.2636 (16.4); 7.1833 (1.8); 7.1786 (1.7);
7.1625 (1.5); 7.1577 (1.4); 7.0807 (0.3); 7.0697 (3.7); 7.0563 (2.9); 7.0514 (2.9); 7.0373 (0.5); 6.7906
(0.8); 6.7754 (1.2); 6.7669 (1.3); 6.7571 (0.8); 6.7503 (0.7); 6.5158 (0.6); 6.5017 (1.1); 6.4866 (0.6);
6.0501 (0.6); 6.0420 (0.6); 6.0342 (0.7); 6.0259 (0.6); 5.9343 (0.6); 5.9261 (0.6); 5.9181 (0.7); 5.9102
(0.6); 4.1768 (0.4); 4.1686 (0.4); 4.1606 (0.4); 4.1518 (0.6); 4.1426 (0.3); 4.1346 (0.3); 4.1141 (0.4);
4.1058 (0.4); 4.0978 (0.4); 4.0897 (0.4); 3.9626 (0.4); 3.9471 (0.7); 3.9313 (0.4); 3.9261 (0.3); 3.9102
(0.6); 3.9046 (0.5); 3.8892 (0.7); 3.8733 (0.4); 3.8677 (0.4); 3.8522 (0.5); 2.9570 (13.7); 2.8818
(12.7); 2.5953 (16.0); 2.5824 (1.1); 2.3167 (0.7); 2.3016 (15.9); 2.0886 (0.6); 2.0802 (0.7); 2.0676
(1.2); 2.0547 (0.8); 2.0463 (0.8); 2.0334 (0.4); 1.6002 (8.7); 1.0177 (0.7); 1.0058 (2.3); 1.0012 (2.4);
0.9899 (1.3); 0.9847 (2.4); 0.9800 (2.4); 0.9691 (1.0); 0.7707 (0.9); 0.7589 (2.9); 0.7554 (2.7); 0.7465
(2.6); 0.7424 (3.0); 0.7303 (0.9); −0.0002 (1.5)
I-343: ¹H-NMR(300.2 MHz, CDCl3):
δ = 8.1323 (5.0); 7.8059 (0.6); 7.3416 (2.4); 7.3345 (2.6); 7.2984 (3.6); 7.2044 (2.0); 7.1771 (2.7);
7.1596 (0.5); 7.1563 (0.5); 7.1329 (1.3); 7.1299 (1.2); 7.1045 (1.4); 7.0914 (1.0); 7.0845 (1.2); 7.0682
(1.0); 7.0625 (1.2); 7.0578 (0.5); 7.0416 (2.2); 7.0347 (2.0); 7.0143 (1.2); 7.0072 (1.2); 6.8847 (0.6);
6.8781 (0.6); 6.8613 (1.0); 6.8587 (0.9); 6.8367 (0.6); 6.8311 (0.5); 4.1907 (0.4); 4.1669 (1.2); 4.1431
(1.2); 4.1193 (0.4); 3.8714 (1.0); 3.8496 (2.4); 3.8294 (2.4); 3.8072 (1.3); 3.8013 (1.2); 3.7929 (0.7);
3.7875 (0.9); 3.7791 (2.6); 3.7711 (1.0); 3.7655 (0.7); 3.7570 (1.1); 3.1283 (1.8); 3.1060 (3.5); 3.0837
(1.7); 2.7407 (16.0); 2.1494 (0.4); 2.1383 (0.5); 2.1210 (0.9); 2.1040 (0.5); 2.0928 (0.5); 2.0782 (5.6);
1.9079 (1.1); 1.8975 (1.1); 1.8859 (3.1); 1.8794 (0.8); 1.8743 (1.1); 1.8638 (1.0); 1.4662 (0.4); 1.3167
(1.5); 1.2929 (3.1); 1.2691 (1.5); 1.0909 (0.7); 1.0757 (1.7); 1.0689 (1.9); 1.0629 (1.0); 1.0541 (1.1);
1.0471 (1.8); 1.0404 (1.7); 1.0259 (0.9); 0.8340 (0.9); 0.8190 (2.0); 0.8127 (2.0); 0.8020 (1.8); 0.7964
(2.1); 0.7799 (0.7); 0.0341 (4.1)
I-344: ¹H-NMR(400.0 MHz, d₆-DMSO):
δ = 9.1164 (0.8); 9.1007 (1.7); 9.0849 (0.8); 7.7434 (0.7); 7.7237 (2.0); 7.7039 (1.8); 7.6902 (6.5);
7.6757 (2.2); 7.6562 (1.1); 7.6079 (2.7); 7.5445 (1.6); 7.5265 (4.0); 7.3669 (1.6); 7.3458 (3.8); 7.3161
(2.1); 7.2944 (0.9); 4.1497 (0.8); 4.1335 (0.8); 4.1130 (1.8); 4.0971 (1.7); 4.0764 (0.9); 4.0605 (0.8);
3.3313 (164.1); 2.6788 (0.5); 2.6001 (16.0); 2.5490 (30.9); 2.5141 (61.1); 2.5097 (81.1); 2.5055
(63.9); 2.4619 (7.7); 2.3368 (0.5)
I-345: ¹H-NMR(499.9 MHz, CDCl3):
δ = 14.9996 (0.9); 8.2820 (1.1); 7.6166 (5.6); 7.6064 (4.3); 7.5895 (0.4); 7.4498 (3.1); 7.4084 (1.1);
7.4034 (1.3); 7.3975 (1.6); 7.3939 (1.4); 7.3859 (0.8); 7.3173 (3.5); 7.3013 (3.9); 7.2586 (11.7);
7.0414 (3.8); 6.9548 (2.1); 6.9389 (1.9); 5.2972 (3.0); 4.2227 (1.3); 4.2109 (1.3); 4.1943 (2.8); 4.1825
(2.7); 4.1659 (1.4); 4.1541 (1.3); 2.4604 (10.7); 2.2827 (16.0); 2.0024 (4.5); 1.5422 (0.4); 1.2843
(0.5); 1.2556 (5.9); 0.8940 (0.5); 0.8803 (0.7); 0.8664 (0.4); 0.8594 (0.4); 0.8457 (0.5); 0.0062
(0.5); −0.0002 (11.7); −0.0068 (0.4)
I-346: ¹H-NMR(400.0 MHz, d₆-DMSO):
δ = 9.2820 (3.0); 9.2625 (3.1); 8.1867 (16.0); 7.9546 (1.2); 7.7604 (1.4); 7.7397 (5.1); 7.7315 (6.1);
7.7219 (4.8); 7.6951 (4.9); 7.6752 (2.2); 7.6476 (3.5); 7.6272 (2.4); 7.6102 (7.1); 7.4271 (6.2); 7.4228
(6.5); 7.4076 (8.2); 7.4032 (8.8); 7.2811 (5.0); 7.2619 (5.7); 7.2420 (3.2); 5.1686 (0.5); 5.1511 (2.1);
5.1329 (3.1); 5.1147 (2.1); 5.0972 (0.5); 3.3758 (48.3); 3.3703 (73.1); 3.3675 (80.8); 2.8927 (8.3);
2.7348 (7.2); 2.5159 (11.2); 2.5116 (23.4); 2.5071 (31.4); 2.5026 (22.7); 2.4983 (11.0); 1.4572 (15.2);
1.4397 (15.0); 1.2399 (0.6); −0.0002 (0.6)
I-347: ¹H-NMR(300.2 MHz, CDCl3):
δ = 8.1798 (5.0); 7.7377 (0.6); 7.6215 (3.5); 7.6185 (3.0); 7.6096 (1.6); 7.6044 (2.3); 7.3941 (1.7);
7.3325 (0.7); 7.3234 (0.9); 7.3133 (1.2); 7.3069 (1.1); 7.2982 (10.5); 7.0275 (1.8); 7.0020 (2.1);
6.9244 (2.0); 6.7576 (1.1); 6.7330 (1.0); 3.8320 (1.0); 3.8098 (2.4); 3.7907 (2.4); 3.7684 (1.1); 2.9863
(1.8); 2.9639 (3.4); 2.9414 (1.6); 2.7486 (16.0); 2.3227 (11.7); 2.2053 (10.8); 1.5998 (9.4); 1.2950
(1.0); 0.1080 (0.7); 0.0487 (0.4); 0.0380 (9.8); 0.0271 (0.4)
I-348: ¹H-NMR(400.0 MHz, d₆-DMSO):
δ = 9.1156 (0.9); 9.0998 (1.9); 9.0842 (0.9); 7.7413 (0.8); 7.7213 (2.2); 7.7012 (2.2); 7.6932 (6.4);
7.6739 (2.5); 7.6544 (1.2); 7.6018 (3.0); 7.5432 (1.8); 7.5233 (1.4); 7.4375 (2.5); 7.4164 (2.9); 7.3835
(3.1); 7.1794 (1.7); 7.1589 (1.5); 4.1542 (0.9); 4.1381 (0.9); 4.1175 (1.9); 4.1017 (1.9); 4.0809 (1.0);
4.0652 (0.9); 3.3304 (125.4); 2.6781 (0.5); 2.5994 (16.0); 2.5485 (25.4); 2.5090 (74.2); 2.4667 (8.7);
2.3359 (0.5)
I-349: ¹H-NMR(400.1 MHz, CDCl3):
δ = 8.4208 (0.3); 8.0072 (2.6); 7.6410 (2.6); 7.6142 (2.6); 7.6021 (3.1); 7.5586 (0.4); 7.5431 (0.4);
7.5252 (0.4); 7.4766 (1.1); 7.4560 (4.9); 7.4485 (3.1); 7.4240 (1.0); 7.3819 (1.1); 7.2609 (13.7);
4.4157 (0.7); 4.4002 (0.8); 4.3796 (1.5); 4.3643 (1.5); 4.3434 (0.8); 4.3281 (0.8); 4.1208 (0.5); 2.9548
(16.0); 2.8782 (15.0); 1.5949 (0.6); −0.0002 (4.0)
I-350: ¹H-NMR(300.2 MHz, CDCl3):
δ = 8.4001 (5.6); 8.3970 (5.7); 8.0318 (0.8); 8.0124 (1.2); 7.9957 (0.8); 7.7172 (0.5); 7.6907 (2.5);
7.6708 (6.8); 7.6680 (6.2); 7.6552 (0.7); 7.5910 (4.1); 7.5551 (3.1); 7.4925 (1.3); 7.4826 (2.0); 7.4750
(1.7); 7.4617 (1.5); 7.4542 (0.9); 7.4324 (0.7); 7.4270 (0.5); 7.4041 (4.9); 7.3957 (7.6); 7.3672 (0.8);
7.2995 (20.0); 6.1380 (0.9); 6.1274 (1.0); 6.1141 (1.0); 6.1035 (1.0); 5.9824 (0.9); 5.9718 (1.0);
5.9585 (1.0); 5.9479 (0.9); 5.2358 (0.4); 5.2145 (1.3); 5.1941 (1.6); 5.1750 (1.4); 5.1538 (0.5); 4.3800
(0.4); 4.3695 (0.4); 4.3576 (0.4); 4.3468 (0.4); 4.3313 (0.5); 4.3205 (0.5); 4.3085 (0.5); 4.2981 (0.5);
4.2891 (0.4); 4.2783 (0.4); 4.2666 (0.5); 4.2555 (0.4); 4.2403 (0.5); 4.2293 (0.5); 4.2178 (0.5); 4.2070
(0.5); 4.1954 (0.5); 4.1716 (1.4); 4.1478 (1.5); 4.1241 (0.5); 3.9071 (0.5); 3.8901 (0.6); 3.8832 (0.6);
3.8661 (0.6); 3.8582 (0.5); 3.8365 (0.9); 3.8190 (0.9); 3.7962 (0.6); 3.7887 (0.5); 3.7715 (0.5); 3.7645
(0.5); 3.7476 (0.4); 3.3632 (2.2); 3.3463 (2.2); 3.3365 (2.1); 3.3198 (2.0); 2.0831 (6.5); 1.6523 (13.7);
1.6303 (13.6); 1.5954 (16.0); 1.3213 (1.7); 1.2975 (3.5); 1.2738 (1.7); 0.0493 (0.7); 0.0383 (19.0);
0.0279 (0.7)
I-351: ¹H-NMR(300.2 MHz, CDCl3):
δ = 8.7887 (2.4); 8.6944 (1.6); 8.6782 (1.6); 7.6311 (0.8); 7.6070 (2.4); 7.6022 (1.5); 7.5962 (1.6);
7.5866 (0.7); 7.5676 (2.3); 7.5364 (1.2); 7.5299 (1.4); 7.5094 (0.6); 7.5014 (0.9); 7.4940 (0.6); 7.4791
(0.6); 7.3419 (1.4); 7.3256 (1.4); 7.2986 (18.5); 7.2367 (0.8); 7.2302 (0.8); 7.2084 (0.7); 7.2016 (0.6);
6.5389 (0.3); 6.5178 (0.5); 4.5217 (0.4); 4.5001 (0.4); 4.4733 (0.8); 4.4519 (0.7); 4.4248 (0.4); 4.4034
(0.4); 2.4323 (1.0); 2.2277 (9.3); 2.0813 (0.5); 1.6033 (16.0); 1.3199 (0.3); 1.2919 (1.4); 0.1067 (0.6);
0.0479 (0.7); 0.0371 (16.5); 0.0261 (0.7)
I-352: ¹H-NMR(400.0 MHz, d₆-DMSO):
δ = 9.1427 (2.9); 9.1227 (2.9); 8.1487 (16.0); 7.9528 (1.7); 7.7589 (1.3); 7.7394 (4.1); 7.7202 (8.9);
7.6970 (4.9); 7.6774 (2.0); 7.6397 (3.4); 7.6350 (2.2); 7.6195 (2.1); 7.0838 (2.9); 7.0641 (4.6); 7.0558
(6.4); 6.9541 (4.9); 6.9346 (3.8); 5.0818 (0.5); 5.0644 (1.8); 5.0461 (2.6); 5.0277 (1.8); 5.0101 (0.4);
3.3616 (53.7); 3.3536 (68.9); 3.3515 (70.2); 2.8911 (11.9); 2.7324 (10.2); 2.6731 (0.4); 2.6684 (0.4);
2.6487 (2.7); 2.6351 (5.3); 2.6201 (2.9); 2.5905 (0.4); 2.5736 (0.7); 2.5464 (1.2); 2.5315 (2.7); 2.5130
(16.8); 2.5086 (33.6); 2.5041 (44.7); 2.4996 (32.2); 2.4952 (16.0); 2.4627 (0.7); 1.6974 (0.7); 1.6601
(7.0); 1.6523 (5.8); 1.6446 (6.9); 1.6339 (2.9); 1.6146 (1.1); 1.6015 (0.5); 1.4221 (13.5); 1.4046
(13.4); 1.2398 (0.7); −0.0003 (1.0)
I-353: ¹H-NMR(499.9 MHz, CDCl3):
δ = 8.1232 (1.0); 7.8580 (3.7); 7.6879 (1.9); 7.5454 (2.1); 7.5088 (5.9); 7.4587 (3.8); 7.3838 (2.7);
7.3210 (0.8); 7.2610 (1.6); 7.0636 (2.2); 7.0491 (2.6); 6.9523 (4.2); 6.9107 (1.4); 6.8741 (2.4); 6.8604
(2.2); 6.7619 (1.1); 5.2896 (6.9); 4.5313 (1.9); 4.1797 (7.3); 3.7342 (3.7); 3.7226 (3.9); 3.0792 (11.9);
2.9143 (5.0); 2.9020 (3.1); 2.8753 (1.6); 2.8041 (0.5); 2.6768 (3.3); 2.4158 (0.4); 2.2907 (13.3);
2.2549 (16.0); 2.2074 (4.1); 2.1752 (0.6); 2.1476 (1.6); 1.5990 (0.4); 1.4644 (0.3); 1.4189 (1.5);
1.2577 (6.3); 1.2227 (1.4); 1.2088 (1.5); 1.1108 (4.3); 0.9909 (0.6); 0.8793 (1.0); 0.8490
(1.2); −0.0002 (1.2)
I-354: ¹H-NMR(400.0 MHz, d₆-DMSO):
δ = 9.1902 (0.9); 9.1746 (1.8); 9.1586 (0.9); 8.2741 (2.7); 8.2699 (3.0); 7.8313 (1.3); 7.8273 (1.4);
7.8102 (1.6); 7.8061 (1.8); 7.7476 (0.8); 7.7278 (2.1); 7.7080 (1.9); 7.6948 (6.5); 7.6822 (2.4); 7.6624
(1.1); 7.6408 (3.0); 7.6194 (2.4); 7.5737 (2.7); 7.5143 (1.5); 7.4941 (1.2); 4.2739 (0.8); 4.2581 (0.9);
4.2407 (1.8); 4.2247 (1.7); 4.2072 (0.9); 4.1910 (0.8); 3.3316 (147.5); 2.6835 (0.4); 2.6791 (0.5);
2.5903 (16.0); 2.5492 (43.0); 2.5143 (56.7); 2.5100 (76.7); 2.5058 (62.5); 2.3368 (0.5); 2.3325 (0.4)
I-355: ¹H-NMR(300.2 MHz, CDCl3):
δ = 8.3007 (16.0); 8.0572 (0.7); 7.7011 (1.8); 7.6613 (1.1); 7.6397 (9.5); 7.6177 (4.3); 7.5830 (5.6);
7.5208 (2.8); 7.4948 (3.4); 7.4308 (2.5); 7.4047 (3.4); 7.3238 (5.4); 7.3043 (31.3); 7.2831 (5.2);
7.2763 (3.3); 7.2684 (1.6); 7.2570 (4.5); 7.2313 (1.8); 3.7898 (10.8); 3.7714 (10.8); 2.9996 (5.4);
2.9262 (4.8); 1.6063 (13.4); 1.2977 (2.0); 1.2757 (0.4); 1.1074 (2.3); 1.0845 (8.6); 1.0711 (8.0);
1.0361 (7.6); 1.0228 (8.5); 0.9996 (2.3); 0.9224 (0.6); 0.8980 (0.5); 0.1131 (1.2); 0.0534 (1.0); 0.0427
(30.1); 0.0318 (1.3)
I-356: ¹H-NMR(400.0 MHz, d₆-DMSO):
δ = 9.0479 (2.0); 9.0267 (2.0); 8.1839 (9.2); 7.7493 (0.7); 7.7293 (2.3); 7.7091 (2.3); 7.6824 (4.7);
7.6775 (4.0); 7.6334 (2.0); 7.6129 (1.4); 7.2155 (2.8); 7.1959 (3.1); 6.9178 (3.8); 6.8956 (2.1); 6.8754
(1.8); 5.1512 (0.5); 5.1359 (1.0); 5.1186 (1.2); 5.1010 (0.5); 3.3339 (237.6); 2.7239 (0.8); 2.7063
(2.1); 2.6910 (2.1); 2.6757 (1.3); 2.6475 (0.3); 2.5414 (31.2); 2.5064 (79.7); 2.5020 (104.2); 2.4976
(78.0); 2.3329 (0.5); 2.3286 (0.6); 2.2175 (16.0); 2.0184 (0.4); 2.0048 (0.6); 1.9951 (0.7); 1.9832
(0.9); 1.9744 (1.0); 1.9603 (0.6); 1.8822 (0.6); 1.8690 (0.7); 1.8572 (0.8); 1.8372 (0.7); 1.8031 (0.4);
1.7805 (0.9); 1.7622 (1.5); 1.7512 (1.8); 1.7368 (1.4); −0.0002 (3.0)
I-357: ¹H-NMR(400.0 MHz, d₆-DMSO):
δ = 9.0254 (1.9); 8.1689 (5.7); 7.9549 (0.6); 7.7710 (0.4); 7.7513 (1.3); 7.7306 (2.1); 7.7277 (2.0);
7.7004 (1.4); 7.6808 (0.7); 7.6545 (1.0); 7.6350 (0.7); 7.4945 (0.3); 7.4875 (3.1); 7.4826 (1.1); 7.4709
(1.2); 7.4658 (4.1); 7.4590 (0.6); 7.3243 (0.5); 7.3174 (4.3); 7.3124 (1.3); 7.3007 (1.0); 7.2957 (3.4);
7.2888 (0.4); 3.3619 (11.3); 3.3566 (12.9); 3.3523 (15.6); 3.3493 (17.8); 2.8923 (4.1); 2.7340 (3.5);
2.5149 (4.1); 2.5104 (8.6); 2.5059 (11.6); 2.5013 (8.3); 2.4968 (4.0); 1.6340 (16.0)
I-358: ¹H-NMR(400.1 MHz, d₆-DMSO):
δ = 9.0258 (2.5); 7.9615 (2.6); 7.8359 (0.7); 7.7811 (5.9); 7.7757 (5.5); 7.7726 (5.3); 7.7598 (5.4);
7.6990 (0.5); 7.6772 (0.5); 7.6420 (0.8); 7.5954 (4.8); 7.5491 (2.0); 7.5321 (4.2); 7.5277 (4.2); 7.5054
(4.0); 7.5002 (3.9); 7.4760 (3.6); 7.4548 (3.1); 7.4339 (1.5); 7.4232 (1.8); 7.3536 (0.4); 7.3229 (0.4);
7.2876 (3.1); 7.2829 (3.0); 7.1527 (1.5); 7.1478 (1.5); 6.0541 (1.6); 5.9377 (1.6); 3.9390 (0.4); 3.9333
(0.4); 3.9021 (1.3); 3.8791 (1.7); 3.8663 (1.8); 3.8518 (1.6); 3.8294 (1.6); 3.8197 (1.4); 3.7753 (0.6);
3.5700 (0.4); 3.3235 (129.7); 3.3184 (117.2); 3.3148 (101.9); 2.9644 (0.4); 2.9044 (10.5); 2.8991
(9.7); 2.7450 (9.9); 2.7398 (9.4); 2.6075 (15.8); 2.6025 (16.0); 2.5143 (21.8); 2.5101 (24.1); 2.4696
(2.1); 2.4643 (2.0); 1.2466 (0.4)
I-359: ¹H-NMR(400.0 MHz, d₆-DMSO):
δ = 9.0888 (1.5); 9.0733 (3.0); 9.0595 (1.5); 8.0788 (13.2); 7.7631 (1.1); 7.7429 (9.1); 7.7241 (3.4);
7.7054 (4.2); 7.6851 (6.4); 7.6033 (2.9); 7.5830 (2.3); 7.4956 (0.5); 7.4754 (15.5); 7.4504 (0.5);
6.0456 (1.0); 6.0326 (1.9); 6.0207 (1.0); 5.9307 (1.0); 5.9176 (2.0); 5.9053 (1.1); 4.0382 (0.5); 4.0206
(0.5); 3.8977 (1.7); 3.8825 (2.6); 3.8727 (1.3); 3.8674 (1.3); 3.8397 (1.9); 3.8253 (2.9); 3.8119 (1.4);
3.3191 (58.1); 2.6710 (0.9); 2.5062 (111.2); 2.5019 (140.9); 2.4976 (103.0); 2.3287 (0.8); 1.9887
(2.0); 1.3978 (16.0); 1.1929 (0.5); 1.1751 (1.1); 1.1571 (0.5); −0.0002 (4.0)
I-360: ¹H-NMR(400.0 MHz, d₆-DMSO):
δ = 9.1717 (1.7); 9.1561 (3.6); 9.1405 (1.8); 7.9987 (16.0); 7.7684 (1.4); 7.7486 (4.2); 7.7290 (4.2);
7.7127 (5.2); 7.6933 (2.1); 7.6486 (5.8); 7.5745 (3.3); 7.5549 (2.6); 7.4240 (5.4); 7.4034 (5.9); 7.2531
(6.8); 6.8610 (3.4); 6.8427 (3.2); 4.2714 (1.6); 4.2558 (1.7); 4.2362 (3.6); 4.2205 (3.5); 4.2009 (1.9);
4.1853 (1.7); 3.3386 (136.8); 3.3345 (144.4); 2.6771 (0.4); 2.6723 (0.6); 2.5425 (57.5); 2.5077 (77.0);
2.5033 (99.3); 2.4990 (72.4); 2.3301 (0.6); 2.3256 (0.4); 2.1662 (0.6); 1.9071 (0.7); 1.8943 (1.4);
1.8856 (1.6); 1.8735 (2.8); 1.8612 (1.8); 1.8527 (1.6); 1.8404 (0.8); 0.9825 (1.7); 0.9713 (5.0); 0.9658
(5.4); 0.9504 (5.1); 0.9451 (5.0); 0.9344 (1.8); 0.6488 (1.8); 0.6375 (6.0); 0.6330 (5.6); 0.6256 (5.5);
0.6207 (6.0); 0.6092 (1.6); −0.0002 (2.4)
I-361: ¹H-NMR(499.9 MHz, CDCl3):
δ = 7.5289 (0.4); 7.5131 (2.0); 7.5002 (5.2); 7.4217 (2.6); 7.3765 (1.0); 7.3713 (1.5); 7.3668 (1.2);
7.3583 (1.3); 7.3502 (2.6); 7.3422 (0.5); 7.3341 (2.6); 7.2587 (3.2); 7.0429 (3.1); 6.9537 (1.6); 6.9378
(1.4); 6.4372 (0.7); 6.4252 (1.3); 6.4133 (0.7); 4.2185 (1.0); 4.2060 (1.0); 4.1891 (2.2); 4.1767 (2.2);
4.1597 (1.2); 4.1473 (1.1); 3.2734 (0.3); 3.2592 (0.8); 3.2450 (1.1); 3.2308 (0.8); 3.2167 (0.4); 2.9212
(0.6); 2.8140 (0.5); 2.4790 (8.6); 2.3099 (0.4); 2.2855 (11.3); 1.9871 (1.4); 1.5840 (0.8); 1.4001
(16.0); 1.3859 (16.0); 1.3435 (0.6); 1.3297 (0.6); 1.2970 (1.1); 1.1308 (0.5); 1.1176 (0.5); −0.0002 (3.3)
I-362: ¹H-NMR(300.2 MHz, CDCl3):
δ = 8.2942 (9.2); 8.2901 (16.0); 8.1185 (2.6); 7.5844 (9.1); 7.5807 (6.8); 7.4255 (3.1); 7.3991 (6.8);
7.3669 (24.0); 7.3636 (16.4); 7.3014 (12.6); 7.2973 (22.6); 7.0968 (4.8); 7.0709 (4.0); 7.0190 (3.8);
7.0157 (4.1); 7.0112 (4.0); 6.9921 (3.2); 6.9888 (3.5); 6.9844 (3.6); 6.9458 (7.0); 6.9403 (6.8); 6.1188
(1.7); 6.1080 (1.8); 6.0959 (1.9); 6.0852 (1.6); 5.9639 (1.7); 5.9531 (1.8); 5.9410 (1.9); 5.9304 (1.6);
5.3402 (1.4); 5.3360 (2.5); 4.3336 (0.8); 4.3226 (0.9); 4.3113 (0.8); 4.3003 (0.8); 4.2847 (1.1); 4.2737
(1.1); 4.2627 (1.0); 4.2515 (1.4); 4.2353 (0.8); 4.2242 (0.9); 4.2134 (0.8); 4.1974 (1.1); 4.1868 (1.0);
4.1754 (1.0); 4.1647 (0.9); 3.9017 (0.9); 3.8843 (1.4); 3.8790 (1.0); 3.8612 (1.1); 3.8532 (0.9); 3.8296
(1.7); 3.8116 (1.9); 3.7884 (1.1); 3.7797 (0.9); 3.7623 (1.1); 3.7396 (0.7); 2.0278 (0.7); 2.0108 (1.6);
1.9994 (2.0); 1.9831 (3.1); 1.9706 (1.9); 1.9662 (1.8); 1.9553 (1.7); 1.9382 (0.9); 1.5887 (15.1);
1.2953 (0.7); 1.0897 (2.0); 1.0744 (6.9); 1.0677 (6.6); 1.0522 (5.1); 1.0458 (7.0); 1.0402 (5.2); 1.0246
(2.4); 1.0023 (0.4); 0.9749 (0.3); 0.8029 (2.6); 0.7875 (8.7); 0.7814 (6.1); 0.7708 (7.8); 0.7656 (6.8);
0.7490 (1.9); 0.1072 (0.6); 0.0410 (13.0); 0.0368 (23.5); 0.0259 (1.0)
I-363: ¹H-NMR(300.2 MHz, CDCl3):
δ = 8.3803 (8.8); 8.0229 (0.7); 8.0049 (1.2); 7.9842 (0.7); 7.7092 (0.3); 7.6831 (2.7); 7.6776 (2.3);
7.6725 (2.3); 7.6651 (6.1); 7.6618 (6.0); 7.6504 (0.5); 7.6453 (0.5); 7.5284 (4.8); 7.4991 (6.4); 7.4773
(1.3); 7.4650 (1.8); 7.4582 (1.7); 7.4465 (1.7); 7.4345 (6.3); 7.4052 (3.2); 7.2992 (20.7); 5.2409 (0.5);
5.2187 (1.5); 5.2015 (1.6); 5.1969 (1.7); 5.1797 (1.6); 5.1579 (0.5); 4.2899 (1.7); 4.2697 (1.6); 4.2423
(3.6); 4.2221 (3.4); 4.1947 (1.8); 4.1745 (1.7); 3.2981 (4.4); 3.2812 (4.3); 1.6547 (13.5); 1.6327
(13.4); 1.6150 (0.3); 1.5925 (16.0); 1.3068 (0.9); 0.9205 (1.0); 0.8975 (0.4); 0.0491 (0.8); 0.0384
(21.7); 0.0275 (0.8)
I-364: ¹H-NMR(400.0 MHz, d₆-DMSO):
δ = 9.1727 (0.9); 9.1530 (0.9); 8.1757 (3.4); 8.1746 (3.8); 8.1712 (2.3); 7.9541 (0.6); 7.7535 (0.5);
7.7340 (1.6); 7.7145 (1.6); 7.7015 (2.2); 7.6912 (2.1); 7.6712 (0.8); 7.6302 (1.3); 7.6105 (0.8); 7.2669
(1.0); 7.2622 (1.2); 7.2353 (1.0); 7.2304 (1.3); 7.1717 (0.8); 7.1499 (1.3); 7.1471 (1.3); 7.0876 (1.4);
7.0657 (2.1); 7.0442 (1.0); 5.1023 (0.7); 5.0839 (1.0); 5.0660 (0.7); 3.7905 (16.0); 3.3893 (14.1);
3.3830 (11.8); 3.3787 (11.4); 3.3730 (13.5); 3.3602 (14.5); 2.8928 (3.9); 2.7341 (3.4); 2.5157 (5.0);
2.5113 (10.7); 2.5067 (14.4); 2.5022 (10.4); 2.4977 (5.0); 1.4360 (5.2); 1.4186 (5.2)
I-365: ¹H-NMR(300.2 MHz, CDCl3):
δ = 9.4984 (0.6); 8.3632 (5.0); 7.6049 (0.6); 7.5791 (1.6); 7.5530 (1.2); 7.4905 (1.5); 7.4649 (0.8);
7.3639 (1.9); 7.3540 (2.6); 7.3459 (1.4); 7.3270 (2.4); 7.2982 (6.0); 7.0658 (2.1); 6.9353 (1.1); 6.9015
(1.5); 6.7132 (2.2); 6.5255 (1.1); 4.7050 (1.1); 4.6880 (1.0); 4.6568 (2.2); 4.6397 (2.1); 4.6086 (1.1);
4.5915 (1.1); 2.7861 (0.5); 2.7544 (16.0); 2.5430 (0.4); 2.5093 (3.5); 2.5026 (6.1); 2.4953 (3.4);
2.4057 (0.4); 2.3111 (8.2); 1.6010 (1.2); 1.2959 (0.4); 0.0389 (6.2)
I-366: ¹H-NMR(400.0 MHz, d₆-DMSO):
δ = 9.1265 (1.0); 9.1122 (2.0); 9.0974 (1.0); 8.1058 (11.0); 7.7607 (0.7); 7.7410 (2.2); 7.7209 (2.4);
7.7015 (6.6); 7.6850 (1.4); 7.6191 (2.2); 7.6002 (1.5); 7.4064 (3.1); 7.3856 (3.8); 7.3079 (0.3); 7.2795
(3.3); 7.2157 (2.0); 7.2113 (1.8); 7.1950 (1.7); 7.1900 (1.6); 5.9610 (0.7); 5.9525 (0.8); 5.9431 (0.8);
5.9339 (0.7); 5.8443 (0.7); 5.8350 (0.8); 5.8254 (0.9); 5.8178 (0.7); 5.7561 (4.2); 3.8398 (0.3); 3.8335
(0.3); 3.8253 (0.3); 3.8120 (0.5); 3.8034 (0.6); 3.7973 (0.6); 3.7884 (0.5); 3.7425 (0.9); 3.7270 (1.2);
3.7190 (0.7); 3.7105 (0.7); 3.6934 (0.8); 3.6783 (0.8); 3.6603 (0.6); 3.6416 (0.3); 3.3191 (42.0);
2.6748 (0.9); 2.6704 (1.2); 2.6659 (0.9); 2.5235 (3.6); 2.5101 (83.0); 2.5059 (167.7); 2.5014 (220.5);
2.4969 (159.0); 2.4926 (77.4); 2.3499 (16.0); 2.3330 (1.2); 2.3280 (1.4); 2.3235 (1.1); 2.2921 (0.3);
1.9884 (0.5); 1.2350 (1.0); 1.1749 (0.5); 1.1634 (0.3); 0.8804 (0.6); 0.1463 (0.5); 0.0079
(4.9); −0.0002 (117.4); −0.0084 (5.2); −0.1497 (0.5)
I-367: ¹H-NMR(499.9 MHz, d₆-DMSO):
δ = 9.0714 (1.6); 9.0595 (3.3); 9.0477 (1.6); 8.0203 (16.0); 7.6482 (4.9); 7.6469 (4.8); 7.5612 (5.5);
7.5444 (6.6); 7.3695 (3.6); 7.3654 (3.6); 7.3525 (6.0); 7.3486 (3.3); 7.3365 (6.4); 7.3208 (3.7); 7.0232
(3.4); 7.0075 (3.2); 6.9949 (2.5); 6.9939 (2.5); 6.9905 (3.0); 6.9789 (2.2); 6.9779 (2.2); 6.9744 (2.8);
6.9379 (4.1); 6.9341 (5.8); 6.9303 (3.3); 6.0402 (1.1); 6.0295 (1.8); 6.0200 (1.1); 5.9479 (1.1); 5.9374
(2.0); 5.9277 (1.1); 3.8773 (1.5); 3.8648 (2.4); 3.8588 (1.3); 3.8526 (1.2); 3.8312 (2.0); 3.8193 (2.9);
3.8109 (1.3); 3.8072 (1.2); 3.3240 (13.9); 3.0802 (1.5); 2.5130 (1.4); 2.5095 (3.1); 2.5060 (4.2);
2.5024 (3.1); 2.4990 (1.4); 1.9932 (0.6); 1.9831 (1.4); 1.9764 (1.5); 1.9664 (2.8); 1.9564 (1.6); 1.9497
(1.5); 1.9395 (0.8); 1.1090 (4.5); 0.9999 (1.7); 0.9912 (4.9); 0.9868 (5.2); 0.9835 (2.4); 0.9785 (2.4);
0.9745 (5.0); 0.9701 (5.0); 0.9619 (1.9); 0.7073 (1.9); 0.6987 (5.5); 0.6947 (5.5); 0.6889 (5.3); 0.6848
(5.8); 0.6759 (1.7)
I-368: ¹H-NMR(400.0 MHz, d₆-DMSO):
δ = 9.1447 (2.1); 8.1982 (4.8); 7.9540 (1.0); 7.7722 (0.5); 7.7549 (3.1); 7.7346 (6.2); 7.7026 (1.5);
7.6830 (0.8); 7.6699 (4.1); 7.6532 (1.9); 7.6486 (3.1); 7.6358 (0.8); 3.3606 (18.1); 3.3557 (21.4);
3.3493 (23.7); 2.8925 (6.6); 2.7333 (5.9); 2.5144 (6.1); 2.5100 (12.9); 2.5055 (17.5); 2.5009 (12.6);
2.4964 (6.0); 1.6458 (16.0)
I-369: ¹H-NMR(300.2 MHz, CDCl3):
δ = 7.5863 (2.6); 7.5826 (2.7); 7.5511 (0.6); 7.5291 (1.1); 7.5064 (0.7); 7.4746 (0.5); 7.4501 (1.2);
7.4474 (1.1); 7.4257 (0.8); 7.4230 (0.8); 7.3939 (7.3); 7.3905 (7.0); 7.3578 (1.2); 7.3310 (1.5); 7.2985
(11.9); 7.0980 (1.1); 6.9154 (2.3); 6.7327 (1.2); 6.4507 (0.4); 6.4322 (0.8); 6.4113 (0.4); 6.0940 (0.6);
6.0833 (0.7); 6.0714 (0.7); 6.0607 (0.6); 5.9391 (0.6); 5.9283 (0.7); 5.9164 (0.7); 5.9057 (0.6); 4.2293
(0.4); 4.2185 (0.4); 4.2075 (0.4); 4.1965 (0.4); 4.1914 (0.4); 4.1422 (0.4); 4.1315 (0.4); 4.1204 (0.4);
4.1095 (0.4); 3.9994 (0.4); 3.9796 (0.5); 3.9573 (0.4); 3.9275 (0.5); 3.9247 (0.5); 3.9049 (0.6); 3.8823
(0.4); 3.8755 (0.3); 3.8559 (0.4); 2.6379 (15.9); 2.6222 (1.1); 2.3421 (16.0); 1.6287 (1.2); 0.1073
(0.7); 0.0481 (0.5); 0.0374 (13.7); 0.0264 (0.5)
I-370: ¹H-NMR(300.2 MHz, CDCl3):
δ = 9.7425 (0.6); 8.4040 (5.1); 7.3710 (1.2); 7.3522 (1.9); 7.3447 (2.7); 7.3256 (2.2); 7.3184 (1.7);
7.2981 (6.5); 7.0619 (2.0); 7.0390 (1.4); 7.0129 (1.2); 6.9945 (1.0); 6.9916 (1.0); 6.9865 (1.2); 6.9837
(1.0); 6.9676 (0.9); 6.9646 (0.8); 6.9597 (1.1); 6.9569 (0.9); 6.9208 (1.1); 6.9037 (1.8); 6.8974 (2.9);
6.8913 (2.0); 4.6992 (1.0); 4.6821 (1.0); 4.6511 (2.2); 4.6340 (2.1); 4.6029 (1.1); 4.5858 (1.1); 2.7461
(16.0); 2.5096 (3.3); 2.5029 (6.0); 2.4954 (3.3); 2.3209 (8.0); 1.9814 (0.5); 1.9701 (0.6); 1.9535 (1.1);
1.9367 (0.6); 1.9255 (0.6); 1.5998 (2.3); 1.3059 (0.7); 1.2992 (0.7); 1.0596 (0.7); 1.0445 (1.9); 1.0375
(2.0); 1.0226 (1.1); 1.0161 (2.0); 1.0096 (1.8); 0.9947 (0.9); 0.9213 (0.7); 0.7820 (0.9); 0.7667 (2.3);
0.7611 (2.0); 0.7504 (1.9); 0.7446 (2.5); 0.7281 (0.7); 0.0393 (6.9)
I-371: ¹H-NMR(400.0 MHz, d₆-DMSO):
δ = 9.1138 (0.9); 9.0982 (2.0); 9.0823 (1.0); 7.8576 (3.4); 7.8539 (3.6); 7.7456 (0.8); 7.7259 (2.4);
7.7060 (2.0); 7.6735 (8.5); 7.6555 (1.4); 7.5912 (3.0); 7.5291 (1.7); 7.5092 (1.5); 7.4964 (2.3); 7.4751
(3.6); 7.4119 (2.2); 7.4079 (2.2); 7.3909 (1.4); 7.3867 (1.4); 4.2936 (0.8); 4.2778 (0.9); 4.2590 (1.8);
4.2433 (1.8); 4.2245 (1.0); 4.2087 (0.9); 3.3521 (13.5); 2.5898 (16.0); 2.5487 (17.8); 2.5134 (6.0);
2.5093 (7.6); 2.5053 (5.6); −0.0002 (0.6)
I-372: ¹H-NMR(400.0 MHz, d₆-DMSO):
δ = 9.1267 (1.0); 9.1122 (2.0); 9.0982 (1.0); 8.1030 (9.8); 7.7616 (0.7); 7.7426 (2.1); 7.7223 (2.2);
7.7044 (6.6); 7.6851 (1.3); 7.6194 (2.1); 7.5999 (1.4); 7.4220 (3.7); 7.3566 (0.4); 7.3319 (9.5); 7.3114
(0.6); 5.9478 (0.7); 5.9395 (0.8); 5.9299 (0.8); 5.9216 (0.7); 5.8303 (0.7); 5.8218 (0.8); 5.8126 (0.9);
5.8035 (0.8); 5.7561 (8.4); 3.8381 (0.3); 3.8104 (0.5); 3.8016 (0.6); 3.7965 (0.5); 3.7870 (0.5); 3.7390
(0.9); 3.7309 (0.7); 3.7243 (1.0); 3.7032 (0.6); 3.6863 (0.8); 3.6702 (0.8); 3.6530 (0.6); 3.6337 (0.3);
3.3187 (27.1); 2.6751 (0.7); 2.6703 (1.0); 2.6660 (0.7); 2.5098 (64.0); 2.5057 (125.1); 2.5013 (162.4);
2.4969 (117.7); 2.4927 (58.5); 2.3460 (16.0); 2.3331 (1.2); 2.3285 (1.2); 2.3236 (0.9); 2.2893 (0.3);
1.9886 (0.5); 1.2352 (0.7); 1.1746 (0.4); 0.1458 (0.4); 0.0074 (4.0); −0.0002 (82.2); −0.0084
(4.1); −0.1499 (0.4)
I-373: ¹H-NMR(400.0 MHz, d₆-DMSO):
δ = 9.1546 (1.7); 9.1344 (1.7); 8.1477 (9.3); 7.9522 (0.4); 7.7600 (0.7); 7.7403 (2.4); 7.7205 (5.2);
7.6977 (2.8); 7.6783 (1.2); 7.6401 (1.9); 7.6199 (1.2); 7.1429 (3.4); 7.1021 (1.3); 7.0825 (2.2); 7.0789
(2.2); 7.0387 (3.5); 7.0193 (1.9); 5.0760 (1.0); 5.0577 (1.5); 5.0392 (1.1); 3.3825 (99.9); 3.3797
(102.7); 2.8917 (2.4); 2.7330 (2.1); 2.5280 (0.4); 2.5146 (9.5); 2.5103 (20.3); 2.5058 (27.5); 2.5013
(20.0); 2.4969 (9.7); 2.1437 (15.3); 2.0683 (16.0); 1.4277 (8.1); 1.4102 (8.2)
I-374: ¹H-NMR(400.1 MHz, d₆-DMSO):
δ = 9.0410 (0.8); 9.0263 (1.6); 9.0117 (0.8); 7.9609 (1.6); 7.7779 (6.2); 7.7249 (0.4); 7.6431 (3.3);
7.6180 (1.2); 7.5973 (2.7); 7.5890 (2.0); 7.5770 (3.9); 7.5559 (3.2); 7.5213 (0.7); 7.4719 (1.5); 7.4517
(2.1); 7.4315 (1.0); 7.4224 (2.2); 7.4173 (3.1); 7.4016 (1.5); 7.3969 (1.5); 7.2814 (2.9); 7.1463 (1.5);
6.0795 (0.6); 6.0686 (0.9); 6.0537 (0.6); 5.9634 (0.6); 5.9529 (0.9); 5.9384 (0.6); 3.9214 (0.5); 3.9053
(0.9); 3.8864 (0.9); 3.8714 (0.9); 3.8617 (0.7); 3.8506 (1.0); 3.8354 (0.7); 3.8264 (0.7); 3.8145 (0.7);
3.8026 (0.5); 3.3178 (126.3); 2.8989 (9.4); 2.7400 (8.8); 2.6023 (16.0); 2.5132 (10.8); 2.5092 (14.0);
2.5054 (10.6); 2.4664 (1.7)
I-375: ¹H-NMR(400.0 MHz, d₆-DMSO):
δ = 9.0579 (0.8); 9.0422 (1.6); 9.0265 (0.7); 7.7333 (0.7); 7.7141 (2.1); 7.7055 (6.4); 7.6945 (1.7);
7.6681 (2.0); 7.6481 (1.0); 7.5918 (2.5); 7.5678 (3.3); 7.5464 (4.5); 7.5312 (1.5); 7.5109 (1.1); 7.4316
(4.2); 7.4103 (3.1); 4.1396 (0.8); 4.1239 (0.8); 4.1048 (1.8); 4.0890 (1.7); 4.0696 (0.9); 4.0542 (0.8);
3.3593 (0.4); 3.3181 (309.4); 2.6743 (1.4); 2.6699 (1.9); 2.6656 (1.4); 2.5898 (16.0); 2.5403 (38.0);
2.5052 (215.9); 2.5008 (288.4); 2.4963 (223.4); 2.3319 (1.4); 2.3275 (1.9); 2.3231 (1.4); −0.0002 (1.0)
I-376: ¹H-NMR(300.2 MHz, CDCl3):
δ = 8.3265 (0.8); 8.2843 (0.4); 8.2723 (16.0); 7.6870 (8.7); 7.6696 (9.8); 7.6413 (0.9); 7.6380 (0.8);
7.5755 (0.4); 7.4822 (7.4); 7.4756 (7.5); 7.4451 (4.4); 7.3574 (0.4); 7.3441 (1.7); 7.3352 (1.8); 7.3284
(2.6); 7.3220 (2.4); 7.3136 (1.7); 7.3016 (3.8); 7.1443 (5.7); 7.1171 (8.6); 7.0205 (5.0); 7.0139 (4.9);
6.9932 (3.3); 6.9866 (3.2); 5.3313 (13.2); 3.9082 (0.4); 3.8134 (0.4); 3.7950 (0.4); 3.7371 (8.9);
3.7185 (8.7); 2.1987 (2.7); 1.7006 (2.9); 1.3349 (0.3); 1.3120 (0.3); 1.2918 (0.7); 1.1323 (2.5); 1.1154
(6.8); 1.1107 (8.0); 1.0945 (3.8); 1.0449 (0.6); 1.0254 (0.5); 0.9756 (3.6); 0.9593 (7.9); 0.9379 (2.3);
0.1117 (2.8); 0.0344 (2.3)
I-377: ¹H-NMR(400.0 MHz, d₆-DMSO):
δ = 9.0357 (1.6); 9.0209 (3.1); 9.0069 (1.6); 8.7404 (0.3); 8.3158 (0.4); 8.1642 (0.4); 8.1178 (0.6);
8.0954 (14.6); 8.0838 (1.9); 7.7580 (1.3); 7.7388 (4.1); 7.7193 (4.4); 7.7025 (5.8); 7.6805 (6.8);
7.6098 (3.3); 7.5906 (2.8); 7.5012 (3.4); 7.4869 (4.4); 7.4806 (4.6); 7.4667 (3.7); 7.2854 (0.5); 7.2720
(0.7); 7.2653 (0.7); 7.2500 (0.6); 7.1697 (4.1); 7.1480 (7.5); 7.1260 (3.6); 6.9836 (0.6); 6.9609 (1.0);
6.9389 (0.5); 6.3056 (1.2); 6.2903 (1.1); 5.7864 (1.1); 5.7757 (1.5); 5.7686 (1.4); 5.7559 (16.0);
5.6677 (1.1); 5.6572 (1.4); 5.6501 (1.3); 5.6401 (1.1); 4.6063 (0.6); 4.5905 (0.8); 4.5738 (0.6); 4.4143
(0.3); 4.4020 (0.4); 4.3963 (0.4); 4.3844 (0.4); 4.0377 (0.7); 4.0202 (0.7); 3.8898 (0.4); 3.8741 (0.6);
3.8550 (1.1); 3.8383 (1.5); 3.8210 (1.5); 3.8074 (2.2); 3.7924 (2.2); 3.7743 (1.1); 3.7559 (1.1); 3.7409
(1.2); 3.7309 (0.9); 3.7197 (0.5); 3.7052 (0.8); 3.6917 (0.6); 3.6670 (0.5); 3.6562 (0.4); 3.6075 (0.5);
3.5945 (0.4); 3.5383 (0.7); 3.5189 (0.8); 3.5060 (0.7); 3.3199 (53.0); 2.8713 (0.5); 2.8445 (0.5);
2.8276 (1.0); 2.8101 (0.4); 2.6704 (1.8); 2.5057 (250.1); 2.5015 (317.2); 2.4972 (231.3); 2.3283 (1.8);
1.9886 (2.8); 1.4013 (4.4); 1.3843 (4.6); 1.3689 (1.0); 1.3501 (0.6); 1.3320 (1.2); 1.3139 (1.2); 1.2954
(0.8); 1.2753 (0.4); 1.2358 (3.4); 1.2063 (0.5); 1.1928 (1.0); 1.1748 (1.8); 1.1642 (0.9); 1.1572 (1.1);
1.1478 (1.4); 1.1299 (0.9); 0.9362 (0.6); 0.9198 (0.6); 0.8805 (3.5); 0.8539 (0.5); 0.1460
(0.6); −0.0002 (148.8); −0.0083 (8.0); −0.1497 (0.7)
I-378: ¹H-NMR(300.2 MHz, CDCl3):
δ = 8.3683 (11.6); 8.0551 (2.0); 7.9230 (1.1); 7.8962 (1.2); 7.6522 (3.7); 7.6501 (3.7); 7.6451 (2.6);
7.6359 (6.7); 7.6328 (6.7); 7.5355 (3.3); 7.5024 (0.4); 7.4892 (1.4); 7.4750 (1.9); 7.4687 (1.7); 7.4593
(1.2); 7.4506 (0.8); 7.3035 (23.2); 6.6384 (8.6); 5.4209 (0.5); 5.4014 (1.2); 5.3779 (1.3); 2.9984
(16.0); 2.9246 (14.5); 2.6391 (1.6); 2.6223 (2.8); 2.3562 (0.4); 2.3179 (1.2); 2.3045 (0.9); 2.2906
(0.8); 2.2738 (0.9); 2.2568 (0.3); 1.9592 (1.1); 1.9362 (2.3); 1.9201 (4.4); 1.9075 (2.5); 1.9007 (2.5);
1.8838 (0.9); 1.8764 (0.8); 1.6153 (12.6); 1.2968 (1.9); 0.9231 (0.4); 0.8968 (0.4); 0.1117 (0.4);
0.0521 (0.7); 0.0413 (24.0); 0.0304 (0.8)
I-379: ¹H-NMR(300.2 MHz, CDCl3):
δ = 9.2839 (2.0); 8.5933 (2.3); 8.3855 (4.7); 8.1069 (0.9); 8.0937 (0.8); 8.0894 (0.9); 8.0809 (1.1);
8.0784 (1.1); 8.0648 (1.0); 7.9575 (0.4); 7.8170 (0.5); 7.8128 (0.5); 7.7939 (0.9); 7.7891 (1.0); 7.7845
(0.5); 7.7662 (0.7); 7.7613 (0.6); 7.7266 (0.8); 7.7229 (0.8); 7.6998 (1.0); 7.6963 (0.7); 7.6759 (0.4);
7.6732 (0.4); 7.5800 (2.3); 7.5716 (1.4); 7.5549 (0.9); 7.3208 (2.0); 7.3166 (1.9); 7.2984 (15.7);
5.3373 (0.6); 5.2045 (2.6); 5.1859 (2.6); 1.6114 (16.0); 0.0474 (0.4); 0.0366 (12.9); 0.0257 (0.4)
I-380: ¹H-NMR(300.2 MHz, CDCl3):
δ = 8.1954 (5.0); 7.9872 (0.6); 7.9611 (0.6); 7.6099 (1.4); 7.5897 (4.0); 7.5866 (3.4); 7.5693 (0.3);
7.5192 (1.8); 7.4693 (0.8); 7.4594 (1.2); 7.4521 (0.9); 7.4468 (0.5); 7.4382 (0.8); 7.4309 (0.4); 7.2985
(1.6); 6.6189 (4.8); 5.3944 (0.6); 5.3703 (0.6); 2.7698 (16.0); 2.6109 (1.4); 2.6004 (1.3); 2.3021 (0.6);
2.2886 (0.5); 2.2759 (0.4); 2.2584 (0.4); 1.9513 (0.5); 1.9435 (0.5); 1.9270 (1.2); 1.9186 (1.2); 1.9088
(2.5); 1.8974 (1.4); 1.8890 (1.3); 1.7208 (0.4); 0.0334 (1.6)
I-381: ¹H-NMR(300.2 MHz, CDCl3):
δ = 9.4227 (1.9); 8.7129 (9.3); 8.7079 (6.1); 8.6980 (6.2); 8.6929 (9.8); 8.0875 (1.3); 8.0680 (2.4);
8.0486 (1.3); 7.6402 (0.7); 7.6138 (4.7); 7.6071 (3.9); 7.6024 (4.1); 7.5954 (11.0); 7.5923 (10.6);
7.5829 (1.4); 7.5685 (0.6); 7.5631 (0.7); 7.5421 (10.9); 7.5369 (6.9); 7.5273 (6.8); 7.5220 (10.7);
7.5031 (6.9); 7.4740 (16.0); 7.4281 (1.0); 7.4215 (0.9); 7.4123 (2.8); 7.3995 (12.2); 7.3826 (3.4);
7.3713 (6.7); 7.2983 (8.7); 5.3303 (0.9); 4.2366 (0.8); 4.2164 (2.6); 4.1963 (2.6); 4.1693 (5.7); 4.1492
(5.5); 4.1223 (2.9); 4.1022 (2.8); 2.2305 (0.4); 2.2174 (0.9); 2.2089 (1.5); 2.1957 (2.1); 2.1870 (2.1);
2.1743 (1.7); 2.1654 (1.0); 2.1522 (0.5); 1.2911 (2.2); 1.2681 (0.5); 0.9141 (0.3); 0.8898 (0.4); 0.4741
(0.6); 0.4599 (0.9); 0.4461 (4.2); 0.4379 (6.5); 0.4337 (7.3); 0.4184 (5.6); 0.4114 (5.0); 0.4038 (4.5);
0.3959 (4.1); 0.3914 (3.7); 0.3876 (3.7); 0.3808 (4.1); 0.3547 (0.8); 0.1072 (1.3); 0.0338 (8.7);
0.0229 (0.4)
I-382: ¹H-NMR(400.1 MHz, d₆-DMSO):
δ = 9.0755 (0.6); 9.0608 (1.3); 9.0461 (0.7); 8.0271 (6.2); 7.6517 (2.3); 7.5715 (2.1); 7.5505 (2.6);
7.4030 (1.2); 7.3867 (1.8); 7.3824 (4.0); 7.3657 (1.5); 7.3618 (2.6); 6.9027 (1.1); 6.8977 (1.3); 6.8827
(1.0); 6.8771 (1.3); 6.8345 (1.4); 6.8291 (2.7); 6.8234 (1.9); 6.8158 (1.7); 6.8112 (1.1); 6.7961 (1.4);
6.7910 (1.1); 6.0555 (0.4); 6.0424 (0.8); 6.0302 (0.5); 5.9397 (0.4); 5.9271 (0.9); 5.9147 (0.5); 3.8897
(0.8); 3.8755 (1.3); 3.8610 (0.7); 3.8315 (0.9); 3.8174 (1.4); 3.8037 (0.9); 3.7792 (16.0); 3.3145
(64.4); 2.8995 (1.7); 2.7406 (1.5); 2.5139 (6.6); 2.5095 (9.1); 2.5052 (7.0)
I-383: ¹H-NMR(300.2 MHz, CDCl3):
δ = 7.6320 (0.5); 7.6061 (2.5); 7.5851 (7.6); 7.5640 (0.7); 7.5231 (3.6); 7.5015 (0.5); 7.4954 (0.4);
7.4844 (1.6); 7.4751 (2.5); 7.4678 (1.6); 7.4613 (1.0); 7.4536 (1.5); 7.4460 (0.9); 7.4087 (3.3); 7.3821
(3.8); 7.2983 (24.9); 7.1897 (1.0); 7.1681 (1.6); 7.1468 (1.0); 7.0868 (3.8); 7.0306 (2.2); 7.0181 (1.2);
7.0040 (1.9); 5.3374 (1.0); 5.0467 (0.6); 4.4120 (0.4); 4.3878 (0.6); 4.3607 (0.6); 4.3363 (0.6); 4.3123
(0.4); 4.1946 (0.6); 4.1708 (1.6); 4.1470 (1.6); 4.1232 (1.0); 4.0958 (1.0); 4.0685 (1.2); 4.0446 (0.6);
3.9347 (0.3); 3.8893 (0.7); 3.8416 (0.6); 3.7981 (0.3); 3.7820 (0.4); 3.7622 (0.6); 3.7382 (1.3); 3.7142
(1.1); 3.6871 (0.4); 2.6536 (1.8); 2.6491 (1.8); 2.6265 (4.4); 2.5980 (3.8); 2.5157 (11.2); 2.4006 (1.0);
2.3761 (2.7); 2.3391 (16.0); 2.3099 (1.9); 2.0827 (7.0); 1.6174 (8.0); 1.4701 (11.4); 1.3207 (2.2);
1.2969 (5.0); 1.2731 (2.2); 1.2133 (0.5); 0.9175 (0.4); 0.8941 (0.4); 0.1196 (1.4); 0.1078 (26.6);
0.0956 (1.2); 0.0484 (1.0); 0.0377 (23.5); 0.0268 (1.0)
I-384: ¹H-NMR(400.0 MHz, d₆-DMSO):
δ = 8.8832 (2.2); 8.1346 (4.9); 7.9528 (0.5); 7.7706 (0.5); 7.7510 (1.4); 7.7298 (1.9); 7.7237 (2.0);
7.6992 (1.6); 7.6801 (0.8); 7.6541 (1.1); 7.6351 (0.8); 7.3786 (3.0); 7.3567 (3.4); 6.8228 (0.4); 6.8151
(3.4); 6.7931 (3.2); 3.7091 (14.0); 3.3743 (42.1); 3.3726 (42.4); 3.3699 (41.9); 3.3685 (41.8); 2.8917
(3.2); 2.7335 (2.9); 2.5100 (10.1); 2.5057 (13.7); 2.5014 (10.3); 1.6328 (16.0)
I-385: ¹H-NMR(400.1 MHz, d₆-DMSO):
δ = 9.1242 (1.2); 9.1088 (2.5); 9.0932 (1.2); 7.9608 (1.6); 7.8204 (0.4); 7.7023 (8.8); 7.6019 (2.2);
7.5819 (3.6); 7.5612 (1.7); 7.4710 (2.3); 7.4512 (3.1); 7.4375 (1.1); 7.4315 (1.4); 7.4185 (1.9); 7.3810
(0.4); 7.3622 (0.4); 7.3299 (3.4); 7.3100 (3.8); 7.2834 (4.1); 7.1482 (2.5); 7.0762 (4.5); 6.9562 (2.4);
6.9356 (2.2); 4.1292 (1.2); 4.1136 (1.4); 4.0921 (2.8); 4.0763 (2.8); 4.0550 (1.5); 4.0392 (1.4); 3.3179
(171.4); 2.8989 (8.9); 2.7401 (8.3); 2.5954 (22.8); 2.5092 (18.1); 2.4629 (1.4); 2.4318 (11.6); 2.3948
(1.9): 2.3106 (1.6): 2.2733 (1.1): 2.2419 (0.3): 2.2119 (16.0): 2.1750 (0.9): 1.2456 (0.4)
I-386: ¹H-NMR(400.1 MHz, d₆-DMSO):
δ = 9.0996 (1.7); 9.0793 (1.8); 7.9595 (0.5); 7.7268 (0.6); 7.7073 (1.8); 7.6881 (1.9); 7.6738 (2.6);
7.6544 (1.0); 7.6306 (2.2); 7.6109 (2.3); 7.5365 (4.4); 7.5142 (1.4); 7.3972 (2.2); 7.3765 (2.6); 7.3147
(4.8); 7.1285 (1.2); 7.1094 (2.0); 7.0907 (1.2); 6.8596 (1.3); 6.8407 (2.1); 6.8222 (1.1); 5.4665 (0.9);
5.4487 (1.3); 5.4305 (0.9); 3.7196 (16.0); 3.3382 (96.5); 2.8973 (2.6); 2.7382 (2.4); 2.5088 (12.1);
2.3413 (15.2); 1.6151 (6.2); 1.5983 (6.2)
I-387: ¹H-NMR(400.0 MHz, d₆-DMSO):
δ = 9.2370 (1.7); 9.2213 (3.6); 9.2056 (1.7); 8.0366 (15.9); 7.7600 (1.3); 7.7405 (4.1); 7.7210 (4.7);
7.7102 (5.4); 7.6904 (1.8); 7.6563 (7.6); 7.6321 (9.0); 7.5796 (3.3); 7.5602 (2.5); 7.4055 (3.2); 7.3853
(2.7); 4.2234 (1.6); 4.2075 (1.7); 4.1872 (3.6); 4.1714 (3.5); 4.1510 (1.8); 4.1352 (1.7); 3.3294
(192.7); 2.7185 (0.4); 2.6829 (0.6); 2.6788 (0.8); 2.6744 (0.6); 2.5607 (16.0); 2.5489 (59.6); 2.5139
(91.7); 2.5095 (121.6); 2.5052 (93.9); 2.3363 (0.8); 2.3319 (0.6)
I-388: ¹H-NMR(400.0 MHz, d₆-DMSO):
δ = 20.0082 (0.4); 9.0215 (2.0); 9.0063 (3.8); 8.9926 (2.0); 8.3142 (0.8); 8.1114 (0.3); 8.0811 (16.0);
7.7668 (1.6); 7.7465 (4.5); 7.7262 (4.5); 7.7093 (6.3); 7.6872 (12.9); 7.6654 (9.9); 7.6042 (3.8);
7.5841 (3.1); 7.5001 (0.7); 7.4796 (0.8); 7.3076 (0.3); 7.2328 (9.1); 7.2123 (8.4); 7.0706 (0.6); 7.0493
(0.6); 6.3043 (0.3); 5.7555 (3.5); 5.7465 (2.0); 5.7316 (1.3); 5.6412 (1.2); 5.6303 (1.7); 5.6132 (1.3);
4.0550 (0.5); 4.0371 (1.5); 4.0196 (1.6); 4.0017 (0.5); 3.8644 (0.4); 3.8479 (0.4); 3.8299 (1.3); 3.8137
(2.4); 3.7969 (2.7); 3.7789 (2.1); 3.7624 (2.0); 3.7460 (2.1); 3.7324 (1.6); 3.7206 (1.1); 3.6992 (0.6);
3.5285 (0.5); 3.5140 (0.4); 3.3178 (163.2); 3.1424 (0.3); 2.8079 (0.4); 2.7889 (0.5); 2.6700 (4.2);
2.5049 (593.4); 2.5008 (756.4); 2.4966 (556.9); 2.3277 (4.3); 1.9881 (6.5); 1.3976 (1.3); 1.3834 (0.8);
1.3072 (0.4); 1.2929 (0.5); 1.2347 (2.0); 1.1923 (1.9); 1.1744 (3.8); 1.1566 (2.1); 1.1470 (1.0); 0.8798
(1.2); 0.8526 (0.4); 0.1452 (1.7); −0.0004 (369.0); −0.1501 (1.8)
I-389: ¹H-NMR(300.2 MHz, CDCl3):
δ = 8.1918 (0.4); 8.1729 (0.8); 8.1525 (0.4); 7.5650 (1.2); 7.5420 (3.7); 7.5196 (0.4); 7.4991 (1.7);
7.4654 (0.8); 7.4566 (1.3); 7.4493 (0.8); 7.4351 (2.3); 7.4088 (1.9); 7.2991 (14.3); 7.0962 (1.9);
7.0595 (1.0); 7.0327 (0.9); 5.3382 (1.6); 4.2626 (0.9); 4.2425 (0.9); 4.2123 (1.9); 4.1923 (1.8); 4.1621
(1.0); 4.1423 (1.1); 3.8554 (1.6); 3.8368 (3.1); 3.8175 (1.8); 3.3993 (16.0); 3.1162 (1.8); 3.0973 (2.9);
3.0784 (1.6); 2.5421 (5.6); 2.5352 (3.2); 2.3266 (7.6); 1.5856 (7.9); 0.1087 (0.4); 0.0498 (0.5); 0.0390
(14.4); 0.0313 (0.4); 0.0297 (0.4); 0.0281 (0.5)
I-390: ¹H-NMR(300.2 MHz, CDCl3):
δ = 8.9918 (3.2); 8.9864 (3.3); 8.9778 (3.3); 8.9724 (3.2); 8.4964 (2.2); 8.4935 (2.6); 8.4916 (2.6);
8.4678 (2.4); 8.4650 (2.8); 8.3765 (0.4); 8.3690 (16.0); 8.3612 (0.4); 8.1570 (2.8); 8.1289 (3.3);
7.9665 (1.4); 7.7451 (2.7); 7.7215 (4.3); 7.7171 (2.6); 7.6933 (3.8); 7.6290 (3.8); 7.6074 (3.1); 7.5839
(8.4); 7.5612 (3.6); 7.5351 (1.0); 7.4975 (3.7); 7.4835 (3.6); 7.4689 (3.4); 7.4549 (3.4); 7.3795 (3.7);
7.3778 (3.7); 7.3251 (1.6); 7.3176 (2.2); 7.3103 (1.2); 7.3073 (1.2); 7.2983 (16.3); 7.2873 (1.2);
5.3342 (6.4); 5.2244 (8.3); 5.2055 (8.2); 2.1482 (0.4); 2.0779 (0.4); 1.6916 (1.2); 1.2903 (0.4); 0.1067
(3.9); 0.0458 (0.4); 0.0425 (0.3); 0.0351 (12.2); 0.0241 (0.4)
I-391: ¹H-NMR(300.2 MHz, CDCl3):
δ = 8.7796 (5.0); 7.9360 (0.4); 7.5638 (1.6); 7.5439 (4.4); 7.5408 (3.9); 7.5280 (0.3); 7.5238 (0.3);
7.4451 (2.1); 7.4187 (0.9); 7.4087 (1.4); 7.4012 (1.0); 7.3965 (0.6); 7.3878 (0.9); 7.3731 (2.1); 7.3464
(2.3); 7.2996 (1.7); 7.0770 (2.3); 7.0419 (0.6); 7.0216 (1.0); 7.0013 (0.6); 6.9769 (1.3); 6.9503 (1.1);
4.2617 (1.0); 4.2410 (1.0); 4.2130 (2.1); 4.1922 (2.0); 4.1642 (1.1); 4.1434 (1.0); 2.9550 (3.2); 2.8537
(2.8); 2.5172 (6.7); 2.5106 (3.8); 2.3351 (16.0); 2.3223 (9.4); 1.2971 (0.6); 0.9198 (0.4); 0.1141 (0.4);
0.0383 (1.6)
I-392: ¹H-NMR(300.2 MHz, CDCl3):
δ = 8.1870 (5.2); 7.9902 (0.7); 7.9640 (0.7); 7.6057 (1.4); 7.5850 (4.2); 7.5642 (0.3); 7.5172 (1.8);
7.4672 (0.8); 7.4573 (1.3); 7.4501 (0.9); 7.4439 (0.5); 7.4364 (0.8); 7.4286 (0.4); 7.2982 (1.1); 6.6135
(4.9); 5.3896 (0.6); 5.3655 (0.7); 2.7638 (16.0); 2.6026 (1.5); 2.5841 (0.9); 2.2979 (0.6); 2.2841 (0.5);
2.2717 (0.4); 2.2544 (0.4); 1.9491 (0.5); 1.9400 (0.5); 1.9231 (1.2); 1.9164 (1.3); 1.9063 (2.6); 1.8950
(1.4); 1.8859 (1.3); 1.8745 (0.5); 0.0304 (1.0)
I-393: ¹H-NMR(400.0 MHz, d₆-DMSO):
δ = 8.9613 (1.4); 8.9398 (1.5); 7.8086 (6.5); 7.7186 (0.6); 7.6991 (1.7); 7.6796 (1.5); 7.6399 (1.9);
7.6203 (3.6); 7.5819 (1.4); 7.5601 (1.1); 7.1942 (2.0); 7.1746 (2.3); 6.9078 (2.7); 6.8821 (1.5); 6.8619
(1.3); 5.1449 (0.8); 5.1279 (0.8); 5.1101 (0.3); 3.3396 (81.2); 2.7169 (0.6); 2.7009 (1.6); 2.6861 (1.7);
2.6718 (1.0); 2.6026 (16.0); 2.5415 (16.6); 2.5243 (1.1); 2.5108 (20.5); 2.5067 (40.0); 2.5022 (51.8);
2.4978 (38.0); 2.2127 (11.6); 2.0081 (0.3); 1.9948 (0.4); 1.9832 (0.6); 1.9723 (0.7); 1.9641 (0.6);
1.9506 (0.5); 1.8885 (0.4); 1.8748 (0.6); 1.8636 (0.6); 1.8445 (0.6); 1.7578 (1.0); 1.7404 (1.5); 1.7301
(1.1); 1.7171 (1.0); −0.0002 (1.0)
I-394: ¹H-NMR(400.0 MHz, d₆-DMSO):
δ = 9.1344 (2.7); 9.1155 (2.8); 8.1586 (15.4); 8.1546 (6.6); 7.9538 (0.4); 7.7510 (1.6); 7.7314 (4.8);
7.7118 (4.8); 7.6995 (6.7); 7.6868 (6.0); 7.6673 (2.6); 7.6243 (3.8); 7.6046 (2.6); 6.9821 (7.3); 6.9784
(9.0); 6.8776 (2.9); 6.8743 (2.9); 6.8576 (5.5); 6.8540 (5.7); 6.8150 (10.9); 6.7951 (5.8); 5.9559 (9.8);
5.9536 (14.0); 5.9427 (11.7); 5.9404 (12.5); 5.0864 (0.5); 5.0689 (2.2); 5.0506 (3.2); 5.0325 (2.3);
5.0148 (0.6); 3.3997 (44.8); 3.3884 (43.2); 3.3846 (50.6); 3.3737 (58.4); 2.8923 (2.5); 2.7338 (2.2);
2.5292 (0.6); 2.5158 (13.1); 2.5114 (27.5); 2.5068 (37.0); 2.5023 (26.7); 2.4979 (12.9); 1.4239 (16.0);
1.4065 (15.8); 1.2389 (0.4); −0.0002 (0.6)
I-395: ¹H-NMR(400.1 MHz, d₆-DMSO):
δ = 9.2307 (0.4); 9.0789 (2.0); 9.0633 (4.2); 9.0476 (2.1); 8.8146 (0.9); 8.8099 (0.9); 8.7212 (6.9);
8.7159 (6.9); 8.1821 (0.4); 8.1767 (0.4); 8.1618 (0.6); 8.1559 (0.5); 8.0021 (3.8); 7.9962 (3.8); 7.9809
(4.5); 7.9751 (4.5); 7.9614 (0.6); 7.8296 (0.7); 7.8086 (0.9); 7.7547 (16.0); 7.7400 (7.6); 7.7189 (6.5);
7.6310 (0.5); 7.6008 (2.0); 7.5838 (3.8); 7.5688 (3.9); 7.5514 (3.9); 7.5327 (2.5); 7.5182 (1.8); 7.4613
(3.6); 7.4415 (4.9); 7.4213 (2.1); 7.4112 (3.4); 7.2762 (7.3); 7.1412 (3.6); 4.2723 (2.2); 4.2571 (2.3);
4.2369 (5.1); 4.2212 (4.8); 4.2010 (2.8); 4.1856 (2.4); 3.3172 (390.2); 3.2682 (0.5); 2.8989 (3.2);
2.7400 (3.0); 2.5956 (40.6); 2.5134 (29.3); 2.5092 (38.3); 2.5050 (28.5); 2.4537 (4.2); 1.2454 (0.7)
I-396: ¹H-NMR(400.0 MHz, d₆-DMSO):
δ = 9.0785 (0.8); 9.0631 (1.7); 9.0476 (0.8); 7.7399 (0.8); 7.7202 (2.3); 7.7120 (6.6); 7.7009 (2.0);
7.6733 (2.2); 7.6538 (1.1); 7.6142 (2.8); 7.5617 (4.3); 7.5418 (4.5); 7.4877 (0.5); 7.4691 (1.7); 7.4514
(1.7); 7.4276 (3.0); 7.4086 (3.4); 7.3906 (1.1); 4.1399 (0.9); 4.1244 (1.0); 4.1039 (2.0); 4.0883 (2.0);
4.0677 (1.0); 4.0522 (1.0); 3.3300 (266.2); 2.6786 (1.0); 2.6743 (0.8); 2.6019 (16.0); 2.5489 (28.5);
2.5138 (112.2); 2.5095 (151.3); 2.5053 (124.2); 2.3362 (1.0); 2.3321 (0.8)
I-397: ¹H-NMR(300.2 MHz, CDCl3):
δ = 8.2886 (7.3); 7.7733 (1.3); 7.6839 (5.3); 7.6725 (2.6); 7.6681 (2.8); 7.6645 (2.9); 7.6372 (0.5);
7.4369 (2.9); 7.3906 (1.2); 7.3820 (1.4); 7.3703 (1.5); 7.3634 (1.3); 7.3525 (0.8); 7.2972 (0.5); 7.0464
(2.8); 7.0209 (3.2); 6.9679 (3.3); 6.5062 (1.8); 6.4808 (1.6); 5.3208 (1.0); 3.6283 (3.2); 3.6118 (3.1);
2.4569 (16.0); 2.1702 (15.6); 2.1023 (0.4); 1.3108 (1.2); 1.0302 (1.3); 1.0096 (4.7); 0.9961 (2.1);
0.9719 (0.6); 0.9483 (0.8); 0.9239 (2.4); 0.9108 (4.9); 0.8903 (1.3)
I-398: ¹H-NMR(400.1 MHz, CDCl3):
δ = 8.1090 (0.6); 8.0946 (0.9); 8.0802 (0.5); 7.5493 (0.6); 7.5292 (4.1); 7.5085 (6.5); 7.4902 (0.6);
7.4478 (2.2); 7.4142 (3.7); 7.3925 (3.1); 7.3854 (1.8); 7.3803 (1.0); 7.3671 (1.0); 7.2601 (7.3); 4.1811
(1.0); 4.1659 (1.0); 4.1443 (2.1); 4.1292 (2.0); 4.1074 (1.0); 4.0923 (1.0); 3.7895 (2.0); 3.7754 (3.4);
3.7613 (2.0); 3.3566 (16.0); 3.0163 (2.1); 3.0019 (3.3); 2.9880 (1.9); 1.5542 (6.9); −0.0002 (5.7)
I-399: ¹H-NMR(400.1 MHz, CDCl3):
δ = 8.2687 (15.7); 8.0164 (2.2); 7.9293 (1.9); 7.5523 (7.3); 7.4945 (1.2); 7.4783 (2.0); 7.4739 (3.0);
7.4579 (3.5); 7.4372 (1.9); 7.3794 (1.6); 7.3755 (1.4); 7.3585 (6.2); 7.3545 (6.6); 7.3440 (9.5); 7.3231
(2.3); 7.2597 (30.1); 7.1062 (1.5); 7.1006 (1.6); 7.0851 (2.6); 7.0815 (3.0); 7.0646 (1.4); 7.0592 (1.4);
7.0243 (2.7); 7.0193 (3.5); 6.9998 (6.4); 6.9782 (2.4); 6.9724 (3.5); 6.9668 (1.7); 6.0573 (1.4); 6.0493
(1.5); 6.0396 (1.5); 6.0317 (1.4); 5.9407 (1.4); 5.9328 (1.5); 5.9231 (1.5); 5.9153 (1.4); 4.2916 (0.7);
4.2835 (0.7); 4.2748 (0.8); 4.2668 (0.8); 4.2550 (0.9); 4.2469 (0.9); 4.2382 (0.9); 4.2300 (0.9); 4.2250
(0.9); 4.2165 (0.8); 4.2080 (0.8); 4.1998 (0.8); 4.1881 (0.9); 4.1800 (0.9); 4.1714 (0.9); 4.1634 (0.8);
3.8464 (0.8); 3.8339 (0.9); 3.8290 (0.9); 3.8160 (0.9); 3.8099 (0.8); 3.7927 (1.6); 3.7800 (1.6); 3.7627
(0.9); 3.7565 (0.8); 3.7437 (0.8); 3.7389 (0.8); 3.7261 (0.7); 2.9544 (16.0); 2.8820 (14.7); 1.5439
(11.9); 0.0078 (1.8); −0.0002 (44.3)
I-400: ¹H-NMR(300.2 MHz, CDCl3):
δ = 8.7360 (1.3); 7.7163 (1.3); 7.5785 (0.7); 7.5525 (2.5); 7.5321 (6.3); 7.4766 (0.7); 7.4503 (0.6);
7.3987 (3.4); 7.3658 (1.6); 7.3566 (2.1); 7.3490 (1.8); 7.3307 (3.9); 7.2984 (11.9); 7.0372 (3.6);
6.9268 (2.0); 6.9007 (1.8); 5.3362 (3.0); 4.2192 (1.5); 4.1995 (1.5); 4.1711 (3.0); 4.1517 (2.9); 4.1231
(1.6); 4.1036 (1.5); 3.9669 (0.4); 3.0294 (0.7); 3.0199 (1.4); 3.0066 (1.4); 2.9963 (1.4); 2.9846 (1.0);
2.9741 (0.6); 2.8371 (16.0); 2.5549 (0.4); 2.5489 (0.4); 2.5229 (0.5); 2.4829 (10.5); 2.2991 (14.2);
1.6298 (2.8); 1.2950 (3.5); 0.9282 (1.1); 0.9052 (3.5); 0.8876 (3.8); 0.8656 (1.5); 0.8384 (0.4); 0.8134
(0.3); 0.7477 (1.3); 0.7327 (3.3); 0.7240 (3.7); 0.6962 (0.9); 0.1086 (0.8); 0.0381 (10.5)
I-401: ¹H-NMR(300.2 MHz, CDCl3):
δ = 9.2324 (13.9); 9.2164 (14.4); 8.3007 (0.5); 8.2899 (14.5); 8.2738 (13.9); 8.0023 (1.7); 7.9851
(2.9); 7.9662 (1.7); 7.7091 (1.0); 7.6828 (6.4); 7.6751 (5.3); 7.6707 (5.7); 7.6641 (16.0); 7.6608
(15.8); 7.6498 (1.5); 7.6448 (1.4); 7.5956 (0.5); 7.5783 (8.7); 7.5497 (11.9); 7.5365 (7.5); 7.5141
(7.6); 7.5105 (7.6); 7.5078 (8.1); 7.4986 (1.6); 7.4918 (1.0); 7.4827 (3.1); 7.4718 (4.6); 7.4649 (4.2);
7.4524 (3.3); 7.4444 (2.0); 7.2988 (18.5); 7.2940 (6.3); 7.2870 (5.3); 7.2654 (4.4); 7.2587 (4.3);
5.3357 (1.7); 4.5042 (4.5); 4.4837 (4.3); 4.4559 (9.4); 4.4354 (9.0); 4.4075 (4.7); 4.3870 (4.5); 3.4040
(0.6); 1.6284 (10.0); 0.0459 (0.5); 0.0351 (12.0); 0.0242 (0.4)
I-402: ¹H-NMR(400.0 MHz, d₆-DMSO):
δ = 9.1184 (2.9); 9.0982 (3.0); 8.1491 (16.0); 7.9532 (1.6); 7.7578 (1.3); 7.7383 (4.0); 7.7183 (8.7);
7.6939 (4.6); 7.6745 (2.1); 7.6309 (3.2); 7.6115 (2.1); 7.2561 (5.7); 7.1111 (2.8); 7.1076 (2.8); 7.0906
(3.0); 7.0870 (3.0); 6.6581 (6.2); 6.6377 (5.8); 5.0969 (0.5); 5.0795 (1.8); 5.0610 (2.6); 5.0427 (1.9);
5.0256 (0.5); 4.4756 (4.6); 4.4539 (8.5); 4.4317 (5.2); 3.3628 (58.9); 3.3562 (82.1); 3.0918 (0.5);
3.0704 (1.0); 3.0526 (1.7); 3.0315 (2.8); 3.0119 (2.3); 2.9920 (2.9); 2.9706 (1.6); 2.9534 (1.0); 2.9316
(0.5); 2.8914 (10.4); 2.7332 (9.1); 2.5134 (11.3); 2.5091 (23.4); 2.5047 (31.4); 2.5002 (23.1); 1.4282
(13.3); 1.4108 (13.2); 1.2404 (0.4); −0.0002 (0.6)
I-403: ¹H-NMR(400.1 MHz, CDCl3):
δ = 7.9982 (1.9); 7.5280 (2.6); 7.5069 (3.5); 7.4940 (1.7); 7.4764 (4.1); 7.3930 (0.8); 7.3739 (1.7);
7.3557 (1.2); 7.3130 (1.6); 7.2930 (2.1); 7.2730 (1.0); 7.2604 (12.1); 7.1521 (1.7); 7.1486 (1.7);
7.1310 (1.5); 7.1275 (1.6); 7.0098 (1.3); 6.8728 (2.6); 6.7359 (1.3); 6.4034 (0.7); 6.3887 (1.2); 6.3731
(0.7); 4.4422 (1.2); 4.4260 (1.2); 4.4068 (2.4); 4.3907 (2.4); 4.3713 (1.3); 4.3551 (1.2); 2.9494 (11.8);
2.8726 (11.5); 2.6072 (0.5); 2.5913 (16.0); 2.2703 (15.9); 2.1768 (0.3); 1.5740 (5.6); −0.0002 (1.3)
I-404: ¹H-NMR(400.0 MHz, d₆-DMSO):
δ = 9.2138 (1.8); 9.1980 (3.6); 9.1822 (1.7); 8.0365 (13.2); 7.7710 (1.4); 7.7514 (4.1); 7.7317 (4.0);
7.7142 (4.9); 7.6946 (2.0); 7.6626 (5.5); 7.5912 (3.2); 7.5719 (2.5); 7.5221 (5.8); 7.3691 (3.9); 7.3480
(6.5); 7.2911 (3.8); 7.2697 (2.2); 4.1648 (1.6); 4.1491 (1.7); 4.1286 (3.6); 4.1127 (3.5); 4.0919 (1.8);
4.0763 (1.7); 3.3289 (360.4); 3.2913 (0.3); 2.6786 (1.6); 2.5487 (18.5); 2.5094 (249.0); 2.5056
(196.9); 2.4592 (16.0); 2.3362 (1.6); 0.0080 (0.5)
I-405: ¹H-NMR(300.2 MHz, CDCl3):
δ = 8.3143 (13.1); 8.0135 (1.3); 7.6595 (1.1); 7.6333 (3.0); 7.6072 (2.3); 7.5485 (2.8); 7.5228 (1.6);
7.4183 (3.4); 7.3937 (2.0); 7.3904 (2.2); 7.3863 (1.8); 7.3721 (4.0); 7.3637 (2.0); 7.3597 (1.7); 7.3558
(1.4); 7.3458 (4.1); 7.3015 (26.1); 7.0782 (3.8); 6.9942 (2.1); 6.9674 (1.8); 6.9320 (2.2); 6.7444 (4.4);
6.5569 (2.2); 5.3411 (5.3); 4.3061 (2.0); 4.2863 (1.9); 4.2581 (4.3); 4.2382 (4.2); 4.2100 (2.2); 4.1902
(2.1); 2.5194 (6.3); 2.5124 (11.5); 2.5049 (6.4); 2.3241 (16.0); 1.5937 (17.9); 1.2950 (0.9); 0.9224
(0.6); 0.1105 (4.6); 0.0513 (0.8); 0.0404 (23.3); 0.0295 (0.8)
I-406: ¹H-NMR(400.0 MHz, d₆-DMSO):
δ = 9.0278 (0.5); 9.0136 (1.0); 8.9987 (0.5); 8.1178 (0.4); 8.0783 (5.1); 7.7550 (0.4); 7.7362 (1.3);
7.7166 (1.4); 7.7046 (1.8); 7.6857 (0.6); 7.6622 (1.9); 7.6387 (16.0); 7.5955 (1.1); 7.5758 (0.8);
5.9339 (0.3); 5.9212 (0.5); 5.9084 (0.3); 5.8162 (0.3); 5.8048 (0.5); 5.7907 (0.3); 5.7561 (1.0); 4.0382
(0.4); 4.0203 (0.4); 3.8914 (0.6); 3.8761 (0.5); 3.8687 (0.5); 3.8532 (0.5); 3.8363 (0.6); 3.8219 (0.6);
3.8090 (0.5); 3.3191 (22.3); 2.6751 (0.4); 2.6709 (0.6); 2.6661 (0.4); 2.5060 (75.2); 2.5016 (97.6);
2.4972 (70.3); 2.3328 (0.4); 2.3284 (0.6); 2.3237 (0.4); 1.9887 (1.6); 1.3321 (0.8); 1.3139 (0.8);
1.2957 (0.4); 1.2356 (0.8); 1.1927 (0.5); 1.1749 (0.9); 1.1571 (0.5); 0.8807 (1.0); 0.0079
(2.2); −0.0001 (50.8); −0.0082 (2.4)
I-407: ¹H-NMR(400.1 MHz, CDCl3):
δ = 8.2663 (16.0); 8.0170 (0.7); 7.8278 (1.9); 7.5540 (7.3); 7.3975 (1.8); 7.3934 (1.5); 7.3766 (6.2);
7.3725 (6.4); 7.3607 (9.5); 7.3399 (2.5); 7.2595 (30.6); 7.2318 (4.2); 7.2147 (5.7); 7.2001 (5.4);
7.1912 (2.1); 7.1761 (0.6); 7.1688 (0.5); 7.1584 (1.5); 7.1544 (1.6); 7.1443 (2.8); 7.1384 (2.6); 7.1310
(1.6); 7.1221 (1.2); 7.1139 (0.8); 6.0663 (1.4); 6.0583 (1.5); 6.0492 (1.6); 6.0413 (1.4); 5.9501 (1.4);
5.9422 (1.5); 5.9330 (1.6); 5.9251 (1.4); 4.2844 (0.8); 4.2763 (0.8); 4.2678 (0.8); 4.2598 (0.8); 4.2478
(0.9); 4.2397 (0.9); 4.2314 (0.9); 4.2230 (1.0); 4.2194 (1.0); 4.2111 (0.8); 4.2025 (0.8); 4.1947 (0.8);
4.1824 (0.9); 4.1744 (0.9); 4.1661 (0.9); 4.1577 (0.8); 3.8944 (0.8); 3.8808 (1.0); 3.8776 (1.0); 3.8640
(0.9); 3.8578 (0.8); 3.8399 (1.6); 3.8266 (1.6); 3.8090 (1.0); 3.8026 (0.8); 3.7892 (0.9); 3.7857 (0.8);
3.7722 (0.7); 2.9546 (5.5); 2.8821 (5.0); 1.5382 (9.6); −0.0002 (45.1); −0.0082 (1.9)
I-408: ¹H-NMR(300.2 MHz, CDCl3):
δ = 8.4683 (0.6); 7.6599 (0.9); 7.6406 (1.6); 7.6213 (0.9); 7.5892 (0.4); 7.5601 (4.6); 7.5552 (3.1);
7.5427 (7.5); 7.5289 (0.5); 7.4044 (3.6); 7.3785 (0.5); 7.3650 (1.7); 7.3561 (4.8); 7.3445 (2.0); 7.3293
(4.8); 7.2985 (2.6); 7.0797 (4.0); 6.9859 (2.2); 6.9593 (1.9); 5.0057 (0.4); 4.9968 (0.7); 4.9751 (6.0);
4.9702 (5.4); 4.9605 (6.7); 4.9436 (1.5); 4.9350 (0.8); 4.6381 (0.5); 4.6169 (2.1); 4.6066 (5.2); 4.5992
(4.3); 4.5890 (1.8); 4.5678 (0.4); 4.2324 (1.6); 4.2123 (1.6); 4.1838 (3.6); 4.1636 (3.4); 4.1353 (1.9);
4.1150 (1.8); 2.5059 (11.6); 2.4992 (6.7); 2.3274 (16.0); 2.3005 (0.4); 2.0746 (0.6); 1.7186 (3.4);
1.3696 (0.3); 1.3458 (0.8); 1.3060 (4.9); 1.2679 (0.4); 0.9427 (1.7); 0.9208 (5.5); 0.8976 (2.0);
0.0395 (2.5)
I-409: ¹H-NMR(400.1 MHz, CDCl3):
δ = 7.9978 (1.0); 7.5056 (0.7); 7.4885 (1.3); 7.4725 (0.8); 7.4028 (0.6); 7.3836 (1.4); 7.3645 (1.0);
7.3103 (3.9); 7.3049 (3.3); 7.2934 (1.9); 7.2731 (0.8); 7.2604 (11.5); 7.2084 (2.4); 7.1878 (2.9);
7.0242 (1.8); 7.0190 (1.8); 7.0036 (1.5); 6.9977 (2.2); 6.8590 (2.5); 6.7220 (1.2); 6.1258 (0.5); 6.1118
(0.9); 6.0974 (0.6); 3.8376 (1.2); 3.8214 (3.2); 3.8052 (3.3); 3.7890 (1.3); 3.0946 (2.3); 3.0778 (4.3);
3.0611 (2.1); 2.9495 (6.9); 2.8732 (6.4); 2.5973 (0.6); 2.5846 (16.0); 2.3124 (15.9); 2.1742 (0.4);
1.5654 (11.3); −0.0002 (1.2)
I-410: ¹H-NMR(300.2 MHz, CDCl3):
δ = 7.3991 (1.9); 7.3725 (2.1); 7.2986 (9.9); 7.1118 (0.3); 7.1016 (0.3); 7.0872 (4.0); 7.0749 (3.7);
7.0710 (3.1); 7.0625 (2.7); 7.0438 (0.4); 6.9803 (1.1); 6.9536 (1.0); 6.8204 (0.7); 6.8070 (0.6); 6.7998
(1.0); 6.7884 (1.2); 6.7754 (0.6); 6.7666 (0.5); 6.4773 (0.4); 6.4563 (0.8); 6.4362 (0.4); 4.3001 (1.0);
4.2791 (1.0); 4.2519 (2.2); 4.2309 (2.1); 4.2037 (1.1); 4.1827 (1.1); 2.6207 (16.0); 2.5384 (6.2);
2.5314 (3.5); 2.3259 (8.4); 2.2778 (15.7); 2.1236 (0.6); 2.1130 (0.7); 2.0956 (1.0); 2.0782 (0.6);
2.0673 (0.6); 1.6130 (7.6); 1.0539 (0.8); 1.0388 (1.9); 1.0319 (2.1); 1.0258 (1.1); 1.0172 (1.2); 1.0101
(2.1); 1.0034 (1.9); 0.9890 (1.0); 0.8041 (1.0); 0.7893 (2.2); 0.7867 (2.0); 0.7829 (2.2); 0.7722 (2.0);
0.7666 (2.4); 0.7502 (0.8); 0.1083 (1.0); 0.0489 (0.4); 0.0382 (11.6); 0.0272 (0.4)
I-411: ¹H-NMR(400.0 MHz, d₆-DMSO):
δ = 9.0694 (0.7); 9.0538 (1.4); 9.0378 (0.7); 7.7331 (0.6); 7.7135 (1.8); 7.6935 (1.8); 7.6872 (6.6);
7.6654 (1.9); 7.6458 (0.9); 7.5980 (2.3); 7.5430 (1.3); 7.5231 (1.0); 7.3095 (2.2); 7.2895 (2.4); 7.0707
(2.5); 6.9254 (1.3); 6.9053 (1.2); 4.1176 (0.7); 4.1014 (0.7); 4.0802 (1.6); 4.0645 (1.6); 4.0429 (0.8);
4.0271 (0.8); 3.3195 (56.7); 2.6704 (0.4); 2.5920 (16.0); 2.5406 (23.6); 2.5101 (22.8); 2.5057 (44.8);
2.5011 (59.7); 2.4966 (45.0); 2.4921 (22.6); 2.4132 (6.6); 2.3280 (0.4); 2.2880 (0.3); 2.2209 (9.4)
I-412: ¹H-NMR(300.2 MHz, CDCl3):
δ = 8.2661 (6.7); 7.7886 (0.9); 7.7734 (0.6); 7.6530 (0.4); 7.6512 (0.4); 7.6367 (3.7); 7.6335 (3.7);
7.6135 (1.8); 7.5874 (0.4); 7.3504 (2.3); 7.3336 (1.0); 7.3259 (1.1); 7.3174 (0.6); 7.3112 (1.0); 7.3039
(1.2); 7.2956 (0.5); 7.1440 (2.4); 7.1143 (1.1); 7.0898 (1.6); 7.0161 (1.0); 6.9912 (2.4); 6.9669 (1.6);
6.9495 (1.9); 6.9244 (0.7); 3.7198 (4.3); 3.7023 (4.2); 2.1647 (12.4); 2.0032 (3.5); 1.3114 (0.4);
0.9667 (16.0)
I-413: ¹H-NMR(400.0 MHz, d₆-DMSO):
δ = 9.1459 (1.2); 9.1304 (2.5); 9.1148 (1.2); 8.0032 (10.9); 7.9597 (0.9); 7.5798 (4.3); 7.5720 (2.8);
7.5631 (3.0); 7.5576 (6.7); 7.5353 (2.7); 7.3256 (4.4); 7.3051 (5.3); 7.2970 (1.9); 7.2879 (1.2); 7.0870
(4.4); 6.9582 (2.3); 6.9380 (2.1); 4.1325 (1.2); 4.1170 (1.2); 4.0956 (2.7); 4.0798 (2.6); 4.0582 (1.4);
4.0427 (1.3); 3.3482 (24.3); 2.8978 (5.9); 2.7389 (5.4); 2.5139 (29.9); 2.5095 (39.1); 2.5053 (29.7);
2.4221 (11.3); 2.2645 (0.8); 2.2443 (16.0); 2.1917 (0.5)
I-414: ¹H-NMR(400.0 MHz, d₆-DMSO):
δ = 9.2487 (3.5); 9.2293 (3.6); 8.2034 (16.0); 8.2006 (8.9); 7.9554 (0.5); 7.7562 (1.4); 7.7369 (4.2);
7.7173 (3.8); 7.6935 (11.4); 7.6735 (2.6); 7.6339 (3.8); 7.6142 (2.5); 7.4873 (1.5); 7.4829 (1.7);
7.4678 (1.6); 7.4631 (1.9); 7.4585 (1.9); 7.4526 (1.8); 7.4378 (1.6); 7.4333 (1.7); 7.3836 (1.4); 7.3623
(3.2); 7.3573 (1.8); 7.3411 (2.3); 7.3358 (3.3); 7.3148 (2.1); 7.2590 (2.2); 5.1640 (0.5); 5.1458 (2.0);
5.1277 (3.0); 5.1096 (2.1); 5.0925 (0.5); 3.3627 (44.2); 3.3558 (59.6); 3.3500 (66.2); 2.8933 (3.0);
2.7346 (2.8); 2.5108 (28.7); 2.5066 (38.1); 2.5024 (28.2); 1.4512 (14.8); 1.4337 (14.7); 1.2397
(0.6); −0.0002 (0.5)
I-415: ¹H-NMR(400.1 MHz, CDCl3):
δ = 8.0030 (2.2); 7.5056 (0.8); 7.4882 (1.4); 7.4710 (0.9); 7.4349 (2.8); 7.4138 (4.2); 7.3931 (3.9);
7.3106 (1.3); 7.2908 (1.9); 7.2698 (0.9); 7.2609 (12.4); 7.2187 (1.7); 7.2139 (1.7); 7.1978 (1.4);
7.1930 (1.4); 7.0114 (1.2); 6.8744 (2.5); 6.7374 (1.2); 6.4548 (0.6); 6.4402 (1.0); 6.4254 (0.6); 6.0490
(0.6); 6.0412 (0.6); 6.0321 (0.6); 6.0243 (0.6); 5.9328 (0.6); 5.9249 (0.6); 5.9156 (0.6); 5.9080 (0.6);
4.1835 (0.4); 4.1755 (0.4); 4.1674 (0.4); 4.1589 (0.4); 4.1551 (0.4); 4.1385 (0.3); 4.1181 (0.4); 4.1101
(0.4); 4.1017 (0.4); 4.0937 (0.4); 3.9403 (0.4); 3.9243 (0.6); 3.9085 (0.4); 3.9040 (0.4); 3.8858 (0.7);
3.8704 (0.7); 3.8531 (0.4); 3.8485 (0.4); 3.8324 (0.4); 2.9507 (15.5); 2.8752 (14.5); 2.6020 (16.0);
2.5866 (0.5); 2.3086 (16.0); 1.5769 (4.6); −0.0002 (1.3)
I-416: ¹H-NMR(400.0 MHz, d₆-DMSO):
δ = 9.0315 (0.7); 9.0155 (1.5); 9.0005 (0.8); 8.6063 (3.1); 8.6016 (3.3); 8.4804 (3.3); 8.4756 (3.1);
7.7484 (6.6); 7.7112 (0.6); 7.6916 (1.8); 7.6721 (1.7); 7.6507 (2.0); 7.6310 (0.9); 7.5852 (2.4); 7.5125
(1.3); 7.4929 (1.0); 4.3601 (0.7); 4.3446 (0.7); 4.3249 (1.6); 4.3091 (1.5); 4.2894 (0.8); 4.2737 (0.7);
3.3189 (553.9); 2.6744 (1.7); 2.6699 (2.3); 2.6656 (1.7); 2.5972 (16.0); 2.5233 (5.6); 2.5098 (130.9);
2.5053 (277.4); 2.5008 (389.2); 2.4962 (292.2); 2.4918 (139.8); 2.3322 (1.6); 2.3276 (2.3); 2.3232
(1.6); 1.0430 (0.5); 1.0280 (0.5); 0.1457 (0.6); 0.0079 (5.1); −0.0003 (148.6); −0.0085
(4.8); −0.1497 (0.7)
I-417: ¹H-NMR(300.2 MHz, CDCl3):
δ = 8.3527 (0.4); 8.3340 (12.9); 8.3071 (1.7); 8.3036 (1.9); 8.3001 (2.0); 8.2968 (1.8); 8.2800 (2.0);
8.2764 (2.1); 8.2729 (2.3); 8.2696 (2.0); 8.1603 (2.9); 8.1529 (5.1); 8.1457 (2.7); 7.8816 (1.4); 7.8640
(0.8); 7.8247 (0.5); 7.7649 (2.3); 7.7376 (5.4); 7.7104 (3.4); 7.6526 (2.5); 7.6492 (2.8); 7.6449 (2.6);
7.6416 (2.4); 7.6254 (1.5); 7.6218 (1.7); 7.6176 (1.6); 7.6142 (1.4); 7.3810 (3.5); 7.3544 (4.0); 7.3013
(34.4); 7.0904 (3.9); 7.0234 (2.1); 6.9959 (1.8); 5.3413 (3.4); 4.3172 (2.0); 4.2974 (1.9); 4.2687 (4.2);
4.2489 (4.1); 4.2202 (2.2); 4.2005 (2.1); 2.5235 (6.4); 2.5167 (11.6); 2.5093 (6.5); 2.3900 (0.8);
2.3691 (0.4); 2.3603 (0.3); 2.3317 (16.0); 2.1932 (0.4); 1.5910 (12.3); 1.2934 (0.6); 0.1098 (0.5);
0.0507 (1.2); 0.0399 (35.0); 0.0289 (1.3)
I-418: ¹H-NMR(400.0 MHz, d₆-DMSO):
δ = 9.2420 (1.7); 9.2263 (3.5); 9.2106 (1.7); 8.0209 (16.0); 7.9935 (6.3); 7.7996 (3.9); 7.7791 (4.6);
7.7524 (1.3); 7.7329 (4.1); 7.7132 (5.2); 7.7052 (5.6); 7.6855 (1.7); 7.5973 (5.6); 7.5487 (3.4); 7.5294
(2.6); 7.4892 (3.3); 7.4685 (2.9); 4.3576 (1.6); 4.3419 (1.7); 4.3236 (3.6); 4.3078 (3.5); 4.2894 (1.8);
4.2735 (1.7); 3.3404 (142.2); 3.3340 (145.2); 2.7132 (0.3); 2.6768 (0.5); 2.6725 (0.7); 2.5428 (87.9);
2.5079 (99.4); 2.5035 (130.3); 2.4992 (94.5); 2.3689 (0.4); 2.3303 (0.7); 2.1683 (1.0); −0.0001 (3.5)
I-419: ¹H-NMR(499.9 MHz, CDCl3):
δ = 7.5392 (3.7); 7.5293 (5.4); 7.4182 (2.8); 7.3671 (1.0); 7.3582 (1.5); 7.3552 (1.4); 7.3493 (1.1);
7.3442 (0.8); 7.2570 (3.6); 7.0573 (2.4); 7.0420 (2.9); 6.9634 (3.2); 6.8713 (1.8); 6.8562 (1.6); 6.0303
(0.7); 6.0190 (1.3); 6.0077 (0.8); 5.2939 (0.4); 3.7687 (1.3); 3.7554 (3.6); 3.7426 (3.8); 3.7293 (1.5);
2.9612 (2.4); 2.9474 (4.8); 2.9337 (2.4); 2.2980 (16.0); 2.2803 (0.9); 2.2532 (15.1); 2.2118 (0.7);
1.5521 (3.2); 1.2566 (0.5); −0.0002 (3.6)
I-420: ¹H-NMR(400.0 MHz, d₆-DMSO):
δ = 9.1209 (3.3); 9.0996 (3.4); 8.2014 (16.0); 7.7495 (1.1); 7.7297 (3.5); 7.7091 (3.5); 7.6827 (9.6);
7.6668 (2.2); 7.6292 (3.3); 7.6097 (2.2); 7.3453 (6.0); 7.2928 (1.5); 7.2718 (9.6); 7.2670 (7.3); 7.2626
(5.7); 7.2457 (0.9); 7.2414 (1.0); 5.7555 (11.2); 5.1539 (0.8); 5.1390 (1.7); 5.1211 (1.8); 5.1043 (0.8);
3.3197 (40.7); 2.8010 (0.4); 2.7745 (1.3); 2.7580 (3.4); 2.7437 (3.6); 2.7299 (1.5); 2.7007 (0.5);
2.6749 (0.9); 2.6705 (1.1); 2.6664 (0.8); 2.5058 (139.3); 2.5015 (180.1); 2.4971 (133.7); 2.3325 (0.8);
2.3281 (1.0); 2.3239 (0.8); 2.0259 (0.8); 2.0122 (0.9); 1.9879 (1.6); 1.9685 (1.0); 1.8953 (0.4); 1.8539
(1.2); 1.8350 (1.3); 1.8118 (0.9); 1.7902 (1.9); 1.7670 (3.0); 1.7500 (2.1); 1.3555 (1.4); 1.2340 (0.5);
0.0078 (1.3); −0.0002 (32.6); −0.0083 (1.2)
I-421: ¹H-NMR(400.1 MHz, CDCl3):
δ = 8.2655 (10.6); 8.0157 (2.3); 7.8664 (1.5); 7.5606 (5.5); 7.4665 (2.6); 7.4595 (3.0); 7.4527 (2.8);
7.4457 (2.7); 7.4098 (1.8); 7.4058 (1.8); 7.3889 (3.8); 7.3849 (4.0); 7.3527 (6.1); 7.3319 (2.8); 7.2722
(2.2); 7.2598 (24.6); 7.2505 (4.3); 7.2305 (3.2); 7.1765 (1.7); 7.1677 (2.6); 7.1600 (1.8); 7.1546 (1.3);
7.1453 (1.6); 7.1377 (1.0); 6.0562 (1.0); 6.0479 (1.1); 6.0381 (1.1); 6.0301 (1.1); 5.9392 (1.0); 5.9314
(1.1); 5.9215 (1.1); 5.9135 (1.1); 4.2937 (0.5); 4.2863 (0.6); 4.2772 (0.6); 4.2691 (0.6); 4.2572 (0.6);
4.2493 (0.7); 4.2405 (0.6); 4.2325 (0.7); 4.2264 (0.6); 4.2181 (0.6); 4.2093 (0.6); 4.2013 (0.5); 4.1897
(0.7); 4.1814 (0.6); 4.1728 (0.7); 4.1649 (0.6); 3.8361 (0.6); 3.8231 (0.7); 3.8184 (0.8); 3.8054 (0.8);
3.7998 (0.7); 3.7823 (1.1); 3.7696 (1.1); 3.7530 (0.7); 3.7472 (0.6); 3.7344 (0.6); 3.7294 (0.6); 3.7164
(0.5); 2.9544 (16.0); 2.8816 (15.4); 1.5436 (9.5); −0.0002 (36.0)
I-422: ¹H-NMR(300.2 MHz, CDCl3):
δ = 7.5620 (1.2); 7.5539 (1.0); 7.5494 (1.1); 7.5431 (3.3); 7.5397 (3.2); 7.5332 (2.1); 7.5041 (2.9);
7.4468 (1.4); 7.4148 (2.8); 7.3869 (2.0); 7.3790 (1.1); 7.3720 (0.9); 7.3594 (0.6); 7.3516 (0.4); 7.2984
(3.3); 7.2245 (0.4); 7.2039 (0.7); 7.1833 (0.4); 4.5292 (1.9); 4.5210 (1.4); 4.5151 (2.0); 4.5087 (1.4);
4.5006 (2.0); 4.2164 (0.7); 4.1953 (0.7); 4.1682 (1.6); 4.1471 (1.5); 4.1200 (0.8); 4.0989 (0.8); 3.7525
(2.1); 3.7446 (1.4); 3.7381 (2.0); 3.7321 (1.4); 3.7239 (1.9); 3.4432 (16.0); 1.6451 (0.3); 1.2924 (0.5);
0.1086 (0.7); 0.0367 (2.8)
I-423: ¹H-NMR(499.9 MHz, d₆-DMSO):
δ = 9.1095 (0.8); 9.0977 (1.8); 9.0857 (0.8); 7.7116 (0.8); 7.6957 (2.0); 7.6798 (1.5); 7.6370 (2.0);
7.6322 (2.5); 7.6300 (2.6); 7.6282 (2.6); 7.6262 (2.6); 7.6219 (1.3); 7.5516 (2.8); 7.5346 (4.7); 7.5303
(2.7); 7.4993 (1.4); 7.4832 (1.2); 7.3776 (1.9); 7.3734 (1.8); 7.3608 (1.6); 7.3566 (1.6); 6.0269 (0.5);
6.0168 (1.1); 6.0066 (0.5); 5.9345 (0.5); 5.9245 (1.1); 5.9142 (0.6); 3.9166 (1.0); 3.9055 (1.6); 3.8943
(1.0); 3.8701 (0.9); 3.8590 (1.6); 3.8478 (1.0); 3.3267 (10.1); 2.5424 (16.3); 2.5132 (0.7); 2.5096
(1.4); 2.5060 (1.9); 2.5024 (1.4); 2.4989 (0.6); 2.1726 (16.0)
I-424: ¹H-NMR(300.2 MHz, CDCl3):
δ = 7.5390 (0.5); 7.5169 (1.0); 7.4943 (0.6); 7.4508 (0.5); 7.4264 (1.1); 7.4238 (1.1); 7.3987 (2.5);
7.3719 (2.1); 7.3383 (1.1); 7.3107 (1.5); 7.2985 (12.2); 7.2847 (0.6); 7.0848 (2.7); 6.9892 (1.1);
6.9629 (0.9); 6.9028 (2.3); 6.7202 (1.1); 6.3936 (0.4); 6.3729 (0.8); 6.3527 (0.4); 4.3036 (1.0); 4.2827
(1.0); 4.2552 (2.2); 4.2342 (2.1); 4.2068 (1.1); 4.1858 (1.1); 2.6328 (16.0); 2.5364 (6.1); 2.5294 (3.5);
2.3198 (8.3); 2.3002 (15.7); 2.0814 (0.4); 2.0423 (0.4); 1.6497 (1.0); 0.1080 (0.7); 0.0490 (0.4);
0.0381 (14.3); 0.0272 (0.5)
I-425: ¹H-NMR(400.0 MHz, d₆-DMSO):
δ = 9.1804 (2.2); 9.1649 (4.6); 9.1493 (2.2); 8.0697 (16.0); 7.7972 (7.4); 7.7765 (11.3); 7.7601 (1.8);
7.7406 (5.3); 7.7207 (6.9); 7.7060 (13.4); 7.6845 (7.6); 7.6253 (7.3); 7.5745 (4.4); 7.5555 (3.3);
4.2192 (2.2); 4.2034 (2.3); 4.1849 (4.9); 4.1690 (4.8); 4.1504 (2.5); 4.1345 (2.3); 3.3293 (226.9);
2.7189 (0.3); 2.6790 (1.2); 2.6751 (0.9); 2.5495 (72.7); 2.5137 (133.7); 2.5099 (176.4); 2.5058
(141.2); 2.3756 (0.4); 2.3367 (1.1)
I-426: ¹H-NMR(400.0 MHz, d₆-DMSO):
δ = 8.9790 (1.4); 8.9652 (2.9); 8.9517 (1.5); 8.1216 (16.0); 8.1152 (1.4); 7.7209 (4.9); 7.7163 (5.3);
7.6931 (1.0); 7.6733 (3.1); 7.6530 (5.6); 7.6424 (11.1); 7.6197 (3.1); 7.6152 (2.6); 7.5723 (3.3);
7.5534 (2.2); 7.3606 (4.1); 7.3388 (3.6); 4.3373 (3.5); 4.3244 (7.0); 4.3113 (3.8); 4.2771 (0.4); 3.7774
(2.0); 3.7642 (5.1); 3.7508 (5.2); 3.7375 (2.1); 3.3401 (77.2); 3.3349 (82.5); 2.6738 (0.3); 2.5440
(38.1); 2.5269 (1.2); 2.5133 (22.9); 2.5091 (46.1); 2.5047 (61.0); 2.5002 (44.0); 2.4960 (21.4); 2.3313
(0.3); −0.0002 (1.7)
I-427: ¹H-NMR(400.0 MHz, d₆-DMSO):
δ = 9.1459 (0.9); 9.1304 (1.9); 9.1147 (0.9); 7.9724 (9.3); 7.4725 (2.7); 7.4513 (3.0); 7.3555 (3.8);
7.3496 (4.0); 7.3226 (2.7); 7.3026 (3.1); 7.1609 (2.2); 7.1549 (2.1); 7.1401 (2.0); 7.1341 (1.9); 7.0875
(3.3); 6.9588 (1.8); 6.9385 (1.6); 4.1252 (0.9); 4.1095 (0.9); 4.0880 (2.1); 4.0722 (2.0); 4.0509 (1.0);
4.0350 (1.0); 3.3434 (26.7); 2.5138 (28.2); 2.5093 (36.9); 2.5049 (27.7); 2.4208 (8.6); 2.3703 (16.0);
2.2632 (0.6); 2.2447 (12.1); 2.1939 (0.3)
I-428: ¹H-NMR(300.2 MHz, CDCl3):
δ = 7.6840 (1.5); 7.6808 (1.5); 7.6783 (1.5); 7.6023 (0.3); 7.5762 (1.0); 7.5507 (2.7); 7.5252 (0.4);
7.5045 (1.4); 7.4762 (3.4); 7.4175 (0.7); 7.4107 (1.1); 7.4032 (0.7); 7.3828 (1.5); 7.3769 (1.3); 7.3547
(0.8); 7.3486 (0.8); 7.2986 (19.9); 6.3890 (0.4); 6.3678 (0.7); 6.3476 (0.4); 5.3379 (0.5); 4.4804 (0.8);
4.4589 (0.7); 4.4322 (1.6); 4.4107 (1.6); 4.3840 (0.8); 4.3624 (0.8); 4.1929 (1.1); 4.1691 (3.4); 4.1453
(3.5); 4.1215 (1.2); 2.6651 (0.4); 2.6458 (11.3); 2.3097 (11.2); 2.0819 (16.0); 1.5994 (4.2); 1.3200
(4.4); 1.2962 (8.8); 1.2724 (4.2); 0.0476 (0.9); 0.0368 (20.5); 0.0259 (0.8)
I-429: ¹H-NMR(400.1 MHz, CDCl3):
δ = 8.2724 (13.3); 8.0154 (2.2); 7.7861 (1.8); 7.5647 (6.1); 7.4187 (2.3); 7.4145 (2.1); 7.3979 (4.3);
7.3936 (4.2); 7.3511 (6.8); 7.3303 (3.7); 7.2908 (1.9); 7.2862 (3.0); 7.2815 (2.2); 7.2710 (2.2); 7.2597
(32.6); 7.2151 (5.2); 7.2127 (5.2); 6.9732 (1.8); 6.9678 (3.3); 6.9624 (1.9); 6.9515 (2.0); 6.9461 (3.4);
6.9407 (1.9); 6.0522 (1.1); 6.0442 (1.3); 6.0343 (1.3); 6.0262 (1.2); 5.9354 (1.2); 5.9276 (1.3); 5.9174
(1.3); 5.9095 (1.3); 4.2895 (0.6); 4.2811 (0.7); 4.2725 (0.7); 4.2643 (0.7); 4.2526 (0.8); 4.2445 (0.8);
4.2355 (0.8); 4.2276 (0.8); 4.2213 (0.8); 4.2134 (0.7); 4.2044 (0.7); 4.1964 (0.7); 4.1848 (0.8); 4.1764
(0.8); 4.1678 (0.9); 4.1598 (0.8); 3.8330 (0.8); 3.8199 (0.8); 3.8149 (0.9); 3.8022 (0.8); 3.7964 (0.8);
3.7809 (1.2); 3.7671 (1.3); 3.7502 (0.9); 3.7444 (0.8); 3.7314 (0.8); 3.7261 (0.8); 3.7135 (0.7); 2.9546
(16.0); 2.8818 (14.9); 1.5415 (13.1); −0.0002 (46.6)
I-430: ¹H-NMR(300.2 MHz, CDCl3):
δ = 8.7477 (0.8); 8.7333 (0.8); 7.9314 (0.5); 7.9256 (0.5); 7.9055 (1.1); 7.8998 (1.1); 7.8796 (0.7);
7.8739 (0.6); 7.6079 (2.0); 7.5864 (3.0); 7.5820 (2.5); 7.5645 (0.4); 7.5296 (1.2); 7.4963 (0.6); 7.4878
(1.0); 7.4767 (1.0); 7.4731 (1.0); 7.4604 (1.0); 7.4568 (1.0); 7.4512 (0.8); 7.4475 (0.6); 7.4348 (0.6);
7.4312 (0.6); 7.2987 (17.2); 7.2625 (1.1); 7.2358 (1.3); 7.0321 (1.3); 6.9542 (0.7); 6.9279 (0.6);
6.6989 (0.6); 4.0318 (0.6); 4.0112 (0.6); 3.9821 (1.3); 3.9615 (1.2); 3.9324 (0.7); 3.9117 (0.6); 2.4159
(3.8); 2.4086 (2.1); 2.2964 (5.0); 1.6141 (16.0); 0.0485 (0.8); 0.0378 (17.4); 0.0268 (0.7)
I-431: ¹H-NMR(499.9 MHz, CDCl3):
δ = 8.8387 (5.6); 8.5089 (1.7); 7.9482 (0.7); 7.9366 (1.3); 7.9249 (0.7); 7.6626 (0.5); 7.6469 (1.9);
7.6319 (7.2); 7.5169 (2.6); 7.4682 (2.1); 7.4512 (4.3); 7.4327 (1.3); 7.4048 (2.0); 7.4024 (2.0); 7.3880
(1.2); 7.3853 (1.2); 7.2616 (5.2); 5.2993 (0.9); 4.4519 (1.0); 4.4397 (1.0); 4.4230 (2.2); 4.4108 (2.1);
4.3940 (1.1); 4.3818 (1.0); 2.4193 (16.0); 2.1373 (0.4); 1.6077 (4.1); 1.2549 (0.7); 1.2494 (0.3);
0.0715 (0.4); −0.0002 (3.6)
I-432: ¹H-NMR(300.2 MHz, CDCl3):
δ = 9.3908 (5.6); 8.0805 (4.6); 8.0716 (4.6); 7.8193 (5.2); 7.8143 (5.1); 7.5588 (5.7); 7.5418 (6.5);
7.5149 (0.5); 7.4688 (4.0); 7.4464 (0.6); 7.4338 (1.7); 7.4254 (1.6); 7.4170 (2.0); 7.4108 (1.6); 7.4038
(1.2); 7.3956 (0.9); 7.3572 (3.4); 7.3306 (3.8); 7.2985 (5.4); 7.0604 (5.1); 7.0365 (2.1); 7.0162 (1.2);
6.9531 (2.3); 6.9268 (2.0); 6.5709 (3.1); 6.5648 (3.9); 6.5565 (2.9); 4.2562 (1.6); 4.2355 (1.6); 4.2071
(3.2); 4.1866 (3.0); 4.1581 (1.6); 4.1488 (0.9); 4.1375 (1.5); 4.1250 (0.5); 2.4967 (11.9); 2.2978
(16.0); 2.0663 (1.7); 1.6835 (1.5); 1.3570 (0.3); 1.3105 (0.9); 1.2942 (2.0); 1.2870 (1.6); 1.2630 (0.7);
0.9550 (0.4); 0.9317 (0.4); 0.9176 (0.4); 0.8938 (0.3); 0.0374 (3.3)
I-433: ¹H-NMR(400.0 MHz, d₆-DMSO):
δ = 8.9089 (2.0); 8.1382 (5.7); 7.9526 (0.5); 7.7732 (0.4); 7.7535 (1.3); 7.7338 (1.3); 7.7214 (1.8);
7.7016 (1.4); 7.6821 (0.8); 7.6561 (1.0); 7.6366 (0.7); 7.3447 (2.7); 7.3242 (3.2); 7.0649 (2.7); 7.0450
(2.3); 3.3752 (29.6); 3.3657 (55.1); 2.8915 (3.6); 2.7328 (3.2); 2.5141 (5.8); 2.5097 (12.2); 2.5051
(16.5); 2.5006 (11.9); 2.4961 (5.7); 2.2439 (8.9); 1.6295 (16.0)
I-434: ¹H-NMR(300.2 MHz, CDCl3):
δ = 8.5596 (1.4); 8.4037 (0.4); 8.3806 (0.4); 8.3193 (0.4); 8.0542 (0.7); 7.6783 (0.4); 7.6443 (0.5);
7.6346 (0.5); 7.6198 (0.5); 7.5542 (1.5); 7.5510 (1.5); 7.4734 (6.7); 7.4582 (6.8); 7.4370 (5.5); 7.3807
(3.0); 7.3179 (3.2); 7.2984 (27.8); 7.2316 (0.3); 7.1820 (0.3); 7.1614 (0.4); 7.0897 (0.6); 7.0295 (5.1);
6.9442 (2.6); 6.9178 (2.2); 5.3368 (0.6); 5.2673 (1.2); 4.4639 (0.5); 4.4403 (0.5); 4.3462 (2.2); 4.3259
(2.2); 4.3041 (2.2); 4.2062 (1.0); 4.1850 (0.8); 4.1679 (1.0); 4.1447 (1.5); 4.1352 (1.4); 4.0947 (2.0);
4.0445 (1.1); 2.9883 (1.1); 2.9040 (0.9); 2.5119 (1.4); 2.4444 (11.1); 2.3775 (0.4); 2.3351 (2.0);
2.2927 (16.0); 2.0811 (1.3); 1.3197 (0.4); 1.2958 (1.0); 1.2720 (0.4); 0.1079 (1.4); 0.0486 (1.1);
0.0379 (26.9); 0.0269 (1.2)
I-435: ¹H-NMR(400.0 MHz, d₆-DMSO):
δ = 9.1358 (0.8); 9.1199 (1.7); 9.1040 (0.8); 7.7338 (0.7); 7.7143 (2.0); 7.6944 (2.0); 7.6871 (6.6);
7.6690 (3.6); 7.6503 (2.4); 7.6289 (2.1); 7.5775 (2.6); 7.5344 (1.5); 7.5140 (1.2); 7.4327 (1.5); 7.4128
(1.2); 4.2068 (0.8); 4.1912 (0.8); 4.1708 (1.7); 4.1548 (1.6); 4.1344 (0.8); 4.1186 (0.8); 3.3793 (0.4);
3.3329 (348.7); 3.2931 (0.5); 3.2788 (0.3); 2.6833 (0.7); 2.6790 (1.0); 2.6745 (0.7); 2.5933 (16.0);
2.5623 (7.6); 2.5491 (33.6); 2.5142 (105.2); 2.5098 (140.9); 2.5054 (110.0); 2.3409 (0.6); 2.3367
(0.9); 2.3323 (0.6)
I-436: ¹H-NMR(300.2 MHz, CDCl3):
δ = 8.2784 (16.0); 7.9526 (2.8); 7.6442 (1.5); 7.6249 (12.5); 7.6020 (5.5); 7.5756 (1.7); 7.3678 (6.7);
7.3116 (3.9); 7.3061 (3.8); 7.2959 (2.9); 7.2892 (3.6); 7.2676 (0.4); 7.1596 (4.9); 7.1352 (5.3); 6.9514
(2.5); 6.9260 (5.2); 6.9006 (3.1); 6.6417 (3.5); 6.6171 (6.1); 6.5925 (2.8); 6.3877 (6.2); 6.3618 (5.6);
4.1862 (0.6); 4.1624 (1.8); 4.1386 (1.8); 4.1148 (0.6); 3.9043 (0.8); 3.8871 (1.4); 3.8681 (1.3); 3.8587
(2.6); 3.8417 (4.6); 3.8222 (5.4); 3.8142 (4.0); 3.8059 (5.4); 3.7840 (7.2); 3.7538 (5.3); 3.7152 (1.6);
3.7019 (2.9); 3.6875 (2.9); 3.6725 (2.2); 3.6577 (1.5); 3.6432 (0.6); 3.4644 (4.0); 3.4519 (3.7); 3.4340
(3.6); 3.4217 (3.2); 3.3366 (2.9); 2.0759 (7.6); 1.3186 (2.4); 1.2949 (4.3); 1.2711 (2.1); 0.0444 (1.0)
I-437: ¹H-NMR(400.0 MHz, d₆-DMSO):
δ = 9.2234 (1.2); 9.2082 (2.5); 9.1926 (1.2); 8.0263 (12.6); 7.9599 (0.7); 7.8873 (5.5); 7.8657 (6.1);
7.4705 (5.7); 7.4492 (5.3); 7.3193 (3.7); 7.2993 (4.1); 7.0784 (4.3); 6.9374 (2.3); 6.9174 (2.1); 4.1263
(1.2); 4.1105 (1.2); 4.0889 (2.8); 4.0732 (2.6); 4.0517 (1.4); 4.0359 (1.3); 3.3487 (31.8); 2.8979 (4.7);
2.7390 (4.1); 2.6785 (0.4); 2.6740 (0.3); 2.5562 (0.4); 2.5421 (0.4); 2.5315 (1.3); 2.5181 (27.0);
2.5138 (53.1); 2.5093 (70.0); 2.5048 (52.2); 2.5006 (26.4); 2.4174 (11.4); 2.3405 (0.3); 2.3360 (0.5);
2.2589 (0.6); 2.2228 (16.0); 2.1777 (0.5)
I-438: ¹H-NMR(300.2 MHz, CDCl3):
δ = 8.2913 (16.0); 7.6634 (2.1); 7.6379 (8.2); 7.6138 (3.2); 7.5884 (1.0); 7.3045 (87.2); 7.2867 (8.6);
7.2826 (8.6); 7.2669 (2.8); 7.2594 (3.5); 7.2512 (4.9); 7.0771 (1.8); 7.0713 (1.9); 7.0540 (3.0); 7.0487
(3.2); 7.0299 (1.7); 7.0241 (1.8); 6.9535 (0.5); 6.7601 (1.6); 6.7397 (5.4); 6.7334 (6.8); 6.7071 (3.3);
6.6828 (0.9); 5.3445 (14.5); 3.4227 (1.4); 3.4069 (2.8); 3.3973 (1.8); 3.3914 (1.8); 3.3819 (2.8);
3.3663 (1.5); 3.2514 (0.7); 3.2227 (1.1); 3.1988 (1.2); 3.1682 (1.8); 3.1382 (1.2); 3.0580 (1.8); 3.0296
(2.0); 3.0039 (1.0); 2.9793 (1.0); 2.4928 (1.2); 2.4614 (1.9); 2.4512 (1.6); 2.4292 (1.2); 2.4185 (2.4);
2.3866 (1.3); 2.0915 (1.6); 2.0866 (1.8); 2.0644 (1.7); 2.0587 (1.6); 2.0497 (1.5); 2.0432 (1.4); 2.0209
(1.4); 1.6073 (3.4); 1.5913 (69.1); 1.5607 (3.6); 1.3455 (3.3); 1.3292 (3.8); 1.3242 (3.4); 1.3081 (3.1);
1.2988 (1.3); 0.2388 (0.4); 0.0542 (2.8); 0.0433 (85.6); 0.0325 (3.0); −0.1547 (0.4)
I-439: ¹H-NMR(400.0 MHz, d₆-DMSO):
δ = 8.8088 (1.6); 8.7946 (3.0); 8.7806 (1.5); 8.1222 (16.0); 7.7591 (1.2); 7.7394 (3.8); 7.7199 (4.0);
7.7050 (4.8); 7.6838 (6.3); 7.5893 (3.1); 7.5700 (2.4); 7.3161 (6.0); 7.2836 (4.0); 7.2635 (5.6); 7.1768
(3.7); 7.1734 (3.5); 7.1570 (2.6); 7.1530 (2.5); 5.7569 (10.6); 3.6105 (0.8); 3.5948 (1.7); 3.5778 (2.0);
3.5618 (3.0); 3.5465 (1.6); 3.5063 (1.3); 3.4907 (2.3); 3.4747 (2.3); 3.4571 (1.4); 3.4423 (1.1); 3.3939
(0.6); 3.3774 (1.8); 3.3596 (2.3); 3.3430 (1.7); 3.3201 (58.2); 2.9201 (0.6); 2.8985 (0.8); 2.8803 (1.6);
2.8640 (1.7); 2.8585 (1.6); 2.8432 (1.4); 2.8194 (1.2); 2.8009 (2.0); 2.7811 (1.7); 2.7591 (0.9); 2.7405
(0.6); 2.6749 (0.6); 2.6704 (0.8); 2.6667 (0.7); 2.5236 (2.7); 2.5059 (109.8); 2.5016 (142.2); 2.4972
(102.7); 2.3281 (0.8); 2.2395 (0.6); 2.2186 (1.2); 2.2044 (1.4); 2.1983 (1.0); 2.1925 (1.2); 2.1860
(1.7); 2.1720 (1.4); 2.1669 (0.9); 2.1517 (0.6); 1.9887 (0.7); 1.8974 (0.7); 1.8813 (1.4); 1.8762 (1.0);
1.8651 (1.6); 1.8603 (1.6); 1.8490 (1.4); 1.8439 (1.4); 1.8329 (0.9); 1.8282 (1.1); 1.8125 (0.6); 1.3558
(1.3); 1.2345 (0.6); 1.1745 (0.4); −0.0002 (1.2)
I-440: ¹H-NMR(300.2 MHz, CDCl3):
δ = 9.4687 (12.7); 8.9157 (6.4); 8.9095 (6.6); 8.0029 (6.6); 7.9967 (6.6); 7.5477 (4.9); 7.5302 (7.6);
7.5172 (0.7); 7.5053 (0.4); 7.4828 (3.8); 7.4602 (0.6); 7.4474 (1.7); 7.4391 (1.5); 7.4324 (2.1); 7.4258
(1.7); 7.4172 (1.2); 7.4091 (0.8); 7.3504 (3.5); 7.3237 (4.0); 7.2988 (6.9); 7.0695 (4.1); 7.0256 (1.1);
7.0052 (2.2); 6.9844 (1.2); 6.9659 (2.3); 6.9389 (2.0); 4.2759 (1.6); 4.2551 (1.5); 4.2265 (3.4); 4.2058
(3.2); 4.1771 (1.8); 4.1563 (1.7); 2.5021 (11.6); 2.3141 (16.0); 2.0690 (1.1); 1.6827 (8.7); 1.3119
(0.4); 1.2926 (0.8); 1.2882 (0.9); 1.2643 (0.4); 0.0368 (5.9)
I-441: ¹H-NMR(300.2 MHz, CDCl3):
δ = 8.2919 (16.0); 7.8813 (1.1); 7.8627 (1.7); 7.6674 (1.3); 7.6442 (2.6); 7.6215 (1.8); 7.6009 (5.7);
7.5722 (8.2); 7.5376 (1.1); 7.5131 (2.6); 7.5107 (2.6); 7.4895 (2.0); 7.4515 (9.9); 7.4227 (8.7); 7.3924
(1.2); 7.2988 (22.9); 7.1352 (2.6); 6.9532 (5.4); 6.7711 (2.7); 5.3375 (0.6); 4.2718 (2.6); 4.2514 (2.5);
4.2249 (5.6); 4.2045 (5.4); 4.1781 (2.8); 4.1577 (2.7); 1.5873 (14.3); 1.2944 (0.9); 0.1083 (1.2);
0.0490 (0.7); 0.0381 (19.7); 0.0272 (0.8)
I-442: ¹H-NMR(300.2 MHz, CDCl3):
δ = 7.6464 (0.4); 7.5931 (0.6); 7.5504 (7.7); 7.4680 (4.5); 7.4062 (5.2); 7.3797 (4.0); 7.2971 (6.2);
7.2878 (2.6); 7.0769 (4.9); 6.9940 (2.7); 6.9684 (2.6); 6.3738 (2.4); 4.2939 (1.6); 4.2734 (1.8); 4.2450
(3.3); 4.2252 (3.4); 4.1955 (1.8); 4.1773 (1.7); 3.1706 (1.8); 3.1458 (5.0); 3.1362 (2.7); 3.1212 (5.2);
3.1117 (2.4); 3.0967 (2.0); 2.5143 (13.4); 2.3089 (16.0); 1.6020 (2.2); 1.3566 (5.6); 1.3468 (3.5);
1.3320 (10.4); 1.3225 (5.0); 1.3074 (5.4); 1.2979 (2.5); 0.1072 (0.4); 0.0367 (5.8); 0.0275 (2.5)
I-443: ¹H-NMR(400.1 MHz, d₆-DMSO):
δ = 8.8897 (0.8); 8.8756 (1.8); 8.8617 (0.9); 7.9597 (1.7); 7.7538 (0.7); 7.7343 (2.0); 7.7146 (2.0);
7.6976 (2.5); 7.6779 (1.1); 7.6303 (3.6); 7.6262 (3.6); 7.5756 (2.9); 7.5410 (1.6); 7.5213 (1.3); 7.3097
(1.2); 7.2891 (4.4); 7.2768 (3.2); 7.2725 (2.9); 7.2565 (0.9); 7.2520 (0.9); 3.6475 (0.9); 3.6316 (2.6);
3.6161 (2.7); 3.6004 (1.1); 3.3375 (121.1); 2.9568 (1.9); 2.9404 (3.7); 2.9240 (1.9); 2.8976 (9.9);
2.7382 (9.0); 2.5131 (10.5); 2.5091 (13.9); 2.5051 (10.6); 2.2724 (16.0)
I-444: ¹H-NMR(400.0 MHz, d₆-DMSO):
δ = 9.2420 (2.9); 9.2227 (3.0); 8.1850 (0.5); 8.1735 (16.0); 7.9551 (1.4); 7.7568 (1.3); 7.7372 (3.9);
7.7178 (3.7); 7.6954 (7.4); 7.6728 (2.2); 7.6291 (3.3); 7.6086 (2.2); 7.4978 (1.0); 7.4916 (8.7); 7.4872
(3.4); 7.4752 (3.6); 7.4704 (13.1); 7.4646 (2.1); 7.3802 (11.1); 7.3591 (7.8); 5.1340 (0.5); 5.1166
(1.9); 5.0985 (2.8); 5.0804 (1.9); 5.0629 (0.5); 3.3622 (33.3); 3.3593 (37.5); 3.3556 (42.9); 3.3518
(48.0); 2.8925 (9.6); 2.7344 (8.3); 2.5288 (0.4); 2.5154 (10.5); 2.5110 (22.2); 2.5065 (29.8); 2.5019
(21.5); 2.4975 (10.3); 1.4464 (13.8); 1.4289 (13.8); 1.2395 (0.6); −0.0002 (0.8)
I-445: ¹H-NMR(300.2 MHz, CDCl3):
δ = 7.5988 (0.4); 7.5731 (1.3); 7.5470 (3.1); 7.5404 (1.8); 7.5194 (0.7); 7.5021 (1.9); 7.4774 (2.1);
7.4487 (5.0); 7.4422 (3.0); 7.4373 (2.1); 7.4252 (0.9); 7.2990 (11.9); 7.2752 (1.6); 7.2684 (1.5);
7.2473 (1.2); 7.2405 (1.1); 6.4183 (0.5); 6.3984 (0.8); 6.3781 (0.5); 6.1081 (0.5); 6.0977 (0.5); 6.0843
(0.5); 6.0742 (0.5); 5.9522 (0.5); 5.9422 (0.5); 5.9281 (0.5); 5.9183 (0.5); 4.2565 (0.4); 4.2461 (0.4);
4.2340 (0.3); 4.2237 (0.4); 4.1916 (0.4); 4.1674 (0.6); 4.1547 (0.4); 4.1435 (0.7); 4.1321 (0.4); 3.9439
(0.3); 3.9248 (0.4); 3.9201 (0.4); 3.9012 (0.4); 3.8950 (0.3); 3.8715 (0.6); 3.8526 (0.7); 3.8291 (0.4);
3.8229 (0.3); 3.0089 (1.2); 2.9840 (3.8); 2.9591 (3.8); 2.9342 (1.3); 2.3644 (16.0); 2.0814 (2.0);
1.6131 (3.2); 1.4108 (4.2); 1.3860 (8.8); 1.3611 (4.2); 1.3454 (0.7); 1.3194 (1.5); 1.3028 (3.4); 1.2959
(3.9); 1.2720 (0.9); 0.9404 (1.2); 0.9187 (3.6); 0.8954 (1.4); 0.0476 (0.4); 0.0367 (12.4); 0.0257 (0.5)
I-446: ¹H-NMR(300.2 MHz, CDCl3):
δ = 8.3023 (13.4); 7.8772 (0.8); 7.8601 (1.3); 7.6633 (1.0); 7.6389 (1.9); 7.6166 (1.2); 7.5313 (0.9);
7.5068 (2.0); 7.5044 (2.0); 7.4832 (1.5); 7.4805 (1.4); 7.4353 (2.2); 7.4079 (2.7); 7.3806 (4.5); 7.3540
(4.1); 7.2987 (18.7); 7.1330 (2.2); 7.0707 (3.8); 6.9904 (2.1); 6.9639 (1.9); 6.9509 (4.5); 6.7687 (2.2);
5.3376 (1.0); 4.3079 (2.1); 4.2879 (2.0); 4.2601 (4.4); 4.2402 (4.2); 4.2124 (2.2); 4.1925 (2.2); 2.5191
(6.6); 2.5122 (11.8); 2.5047 (6.5); 2.3072 (16.0); 1.5881 (9.5); 1.2944 (0.6); 0.1090 (1.0); 0.0496
(0.6); 0.0388 (16.6); 0.0278 (0.6)
I-447: ¹H-NMR(300.2 MHz, CDCl3):
δ = 8.3031 (13.0); 7.9551 (1.4); 7.5540 (1.5); 7.5507 (1.9); 7.5483 (1.8); 7.5449 (1.7); 7.5272 (2.4);
7.5240 (2.7); 7.5215 (2.9); 7.5183 (2.5); 7.4302 (3.5); 7.4228 (3.4); 7.4158 (5.0); 7.4091 (3.4); 7.4032
(6.0); 7.3759 (3.8); 7.3719 (3.8); 7.3449 (4.2); 7.3015 (34.9); 7.2240 (2.3); 7.2209 (2.4); 7.2165 (2.2);
7.2132 (2.1); 7.1965 (1.8); 7.1936 (1.8); 7.1890 (1.8); 7.1859 (1.6); 7.0839 (4.0); 7.0057 (2.1); 6.9789
(1.8); 5.3416 (5.7); 4.2989 (2.0); 4.2791 (2.0); 4.2509 (4.3); 4.2311 (4.2); 4.2029 (2.2); 4.1831 (2.1);
2.5190 (6.4); 2.5120 (11.8); 2.5046 (6.5); 2.4667 (0.4); 2.3721 (0.6); 2.3415 (16.0); 1.5890 (15.9);
1.2946 (0.6); 0.1102 (1.0); 0.0513 (1.1); 0.0405 (35.4); 0.0295 (1.2)
I-448: ¹H-NMR(300.2 MHz, CDCl3):
δ = 8.3520 (14.5); 7.7986 (1.8); 7.7144 (0.4); 7.6870 (4.1); 7.6703 (8.4); 7.6671 (8.2); 7.6497 (0.8);
7.5593 (4.0); 7.5066 (1.7); 7.4930 (2.1); 7.4865 (2.2); 7.4767 (1.8); 7.4681 (1.0); 7.3038 (84.9);
7.2800 (1.2); 7.2641 (2.0); 7.2507 (3.2); 7.2377 (2.2); 7.2252 (7.0); 7.2142 (5.5); 7.2070 (3.8); 7.1959
(4.4); 6.9529 (0.3); 6.8143 (0.5); 6.8019 (2.5); 6.7903 (2.7); 6.7852 (2.0); 6.7729 (2.1); 3.3281 (1.4);
3.3141 (2.0); 3.3015 (2.2); 3.2884 (2.3); 3.2725 (1.5); 3.1403 (3.5); 3.1156 (5.6); 3.0904 (3.8); 2.1794
(4.9); 2.1677 (0.8); 2.1545 (6.6); 2.1295 (4.2); 2.0522 (16.0); 1.6492 (2.9); 1.6284 (3.7); 1.6230 (3.2);
1.6021 (4.3); 1.5905 (58.5); 1.3306 (0.3); 1.2984 (1.7); 1.1672 (2.4); 1.1501 (3.3); 1.1299 (2.3);
0.2383 (0.4); 0.0536 (2.9); 0.0428 (83.3); 0.0319 (2.7)
I-449: ¹H-NMR(400.1 MHz, CDCl3):
δ = 8.6908 (7.0); 8.6866 (7.2); 8.5134 (6.6); 8.5076 (6.9); 8.2671 (14.6); 8.0131 (2.4); 7.8265 (4.3);
7.8212 (7.3); 7.8161 (4.5); 7.7826 (2.3); 7.4870 (5.8); 7.4656 (12.2); 7.4280 (11.7); 7.4067 (5.9);
7.2602 (26.9); 4.2172 (2.6); 4.2021 (2.7); 4.1811 (5.7); 4.1660 (5.6); 4.1448 (3.0); 4.1297 (2.9);
2.9548 (16.0); 2.8804 (15.2); 1.5556 (1.5); −0.0002 (39.6)
I-450: ¹H-NMR(300.2 MHz, CDCl3):
δ = 8.9235 (6.1); 8.4483 (3.3); 8.0161 (0.4); 7.9980 (0.7); 7.9789 (0.5); 7.6902 (1.4); 7.6698 (3.9);
7.6493 (0.3); 7.5860 (2.4); 7.5631 (1.7); 7.5041 (0.7); 7.4945 (1.2); 7.4872 (0.9); 7.4730 (0.8); 7.4661
(0.5); 7.3993 (3.6); 7.3950 (6.4); 7.2985 (10.2); 6.1409 (0.5); 6.1302 (0.6); 6.1169 (0.6); 6.1062 (0.5);
5.9853 (0.5); 5.9746 (0.6); 5.9614 (0.6); 5.9508 (0.5); 4.3284 (0.3); 4.3060 (0.3); 4.2484 (0.3); 4.2259
(0.3); 3.8987 (0.3); 3.8746 (0.3); 3.8457 (0.5); 3.8285 (0.5); 2.4644 (16.0); 1.6136 (9.1); 1.2934 (0.4);
0.0483 (0.3); 0.0375 (9.3)
I-451: ¹H-NMR(499.9 MHz, CDCl3):
δ = 8.8526 (5.5); 7.9193 (0.5); 7.9079 (1.0); 7.8967 (0.6); 7.6571 (0.3); 7.6411 (1.7); 7.6287 (4.1);
7.6282 (4.1); 7.4960 (2.3); 7.4831 (2.8); 7.4661 (4.1); 7.4350 (0.8); 7.4297 (1.3); 7.4253 (1.0); 7.4169
(1.0); 7.3908 (3.8); 7.3739 (2.7); 7.2623 (3.1); 5.2979 (1.6); 4.2276 (0.9); 4.2155 (0.9); 4.1991 (2.0);
4.1870 (2.0); 4.1705 (1.0); 4.1584 (1.0); 4.0690 (0.6); 3.9455 (16.0); 2.3756 (15.4); 2.3627 (0.7);
1.5785 (0.9); −0.0002 (3.0)
I-452: ¹H-NMR(300.2 MHz, CDCl3):
δ = 8.9120 (5.6); 7.9800 (0.4); 7.9614 (0.6); 7.9435 (0.4); 7.6872 (1.3); 7.6773 (1.2); 7.6677 (3.6);
7.6645 (3.1); 7.6516 (0.5); 7.5892 (2.2); 7.5538 (1.6); 7.4948 (0.7); 7.4840 (1.0); 7.4767 (1.0); 7.4725
(0.6); 7.4640 (0.8); 7.4562 (0.5); 7.4326 (0.4); 7.4046 (2.6); 7.3986 (4.1); 7.3687 (0.4); 7.2982 (3.8);
6.1395 (0.4); 6.1289 (0.5); 6.1156 (0.5); 6.1049 (0.5); 5.9840 (0.5); 5.9733 (0.5); 5.9599 (0.5); 5.9493
(0.5); 5.3339 (1.3); 4.2186 (0.4); 4.0990 (0.8); 3.9813 (16.0); 3.8768 (0.3); 3.8599 (0.3); 3.8521 (0.4);
3.8308 (0.5); 3.8138 (0.4); 3.8077 (0.3); 2.4140 (15.0); 2.4011 (1.1); 1.6169 (1.0); 0.0354 (2.1)
I-453: ¹H-NMR(400.1 MHz, d₆-DMSO):
δ = 8.8191 (0.8); 8.8051 (1.6); 8.7910 (0.8); 7.7526 (0.6); 7.7332 (1.9); 7.7134 (1.8); 7.6946 (2.2);
7.6750 (1.0); 7.5736 (2.6); 7.5380 (1.5); 7.5181 (1.2); 7.2763 (2.7); 7.2552 (5.8); 7.2199 (6.5); 7.1989
(3.1); 3.6123 (0.9); 3.5963 (2.4); 3.5808 (2.6); 3.5648 (1.1); 3.3165 (17.8); 2.8995 (1.1); 2.8535 (1.8);
2.8370 (3.4); 2.8206 (1.8); 2.7407 (1.0); 2.5141 (7.5); 2.5097 (10.3); 2.5054 (7.8); 2.2427 (16.0)
I-454: ¹H-NMR(400.0 MHz, d₆-DMSO):
δ = 9.3231 (2.0); 9.3030 (2.0); 8.2034 (9.2); 7.9533 (0.6); 7.8290 (4.0); 7.7535 (6.4); 7.7447 (3.2);
7.7317 (3.8); 7.7247 (3.2); 7.7094 (3.3); 7.6899 (1.2); 7.6566 (2.2); 7.6277 (4.2); 7.5815 (2.7); 7.5606
(3.2); 7.5303 (2.3); 7.5264 (2.5); 7.5090 (1.9); 7.5052 (2.1); 7.2895 (2.3); 7.2862 (2.5); 7.2685 (2.0);
7.2651 (2.1); 5.3032 (1.2); 5.2851 (1.7); 5.2666 (1.2); 3.3617 (33.2); 3.3575 (32.8); 3.3488 (39.6);
2.8899 (3.6); 2.7322 (3.2); 2.5264 (0.5); 2.5129 (11.1); 2.5087 (22.9); 2.5042 (30.7); 2.4998 (22.3);
2.4394 (16.0); 2.3670 (0.3); 1.5490 (8.4); 1.5316 (8.3); −0.0002 (0.5)
I-455: ¹H-NMR(300.2 MHz, CDCl3):
δ = 8.0317 (0.6); 7.5965 (2.5); 7.5756 (1.3); 7.5507 (3.0); 7.5421 (1.7); 7.5210 (0.7); 7.5047 (1.9);
7.4547 (0.9); 7.4484 (1.4); 7.4413 (0.7); 7.4327 (0.6); 7.4245 (0.9); 7.4170 (0.6); 7.4013 (6.6); 7.2986
(16.1); 6.4123 (0.5); 6.3918 (0.8); 6.3731 (0.5); 6.0932 (0.6); 6.0830 (0.6); 6.0694 (0.6); 6.0593 (0.6);
5.9375 (0.5); 5.9274 (0.6); 5.9138 (0.6); 5.9037 (0.5); 4.2566 (0.3); 4.2463 (0.4); 4.2342 (0.3); 4.2236
(0.4); 4.1654 (0.4); 4.1550 (0.3); 4.1428 (0.4); 4.1324 (0.3); 3.9454 (0.3); 3.9263 (0.4); 3.9216 (0.4);
3.9025 (0.4); 3.8728 (0.7); 3.8538 (0.7); 3.8302 (0.4); 3.0108 (1.2); 2.9859 (3.7); 2.9610 (3.8); 2.9362
(1.2); 2.3630 (16.0); 2.0447 (1.6); 1.6321 (0.7); 1.4112 (4.2); 1.3863 (8.8); 1.3711 (0.8); 1.3614 (3.9);
1.2932 (0.8); 0.0469 (0.6); 0.0361 (15.9); 0.0252 (0.5)
I-456: ¹H-NMR(300.2 MHz, CDCl3):
δ = 8.4189 (1.1); 8.3988 (0.7); 8.3322 (10.8); 8.3212 (3.0); 8.3140 (2.9); 7.8540 (1.8); 7.8461 (1.8);
7.8258 (2.8); 7.8180 (2.7); 7.7259 (4.4); 7.6978 (2.8); 7.6637 (0.8); 7.6381 (1.5); 7.6236 (0.8); 7.6148
(0.8); 7.4821 (0.6); 7.4608 (1.7); 7.4401 (2.3); 7.4350 (4.6); 7.4107 (2.1); 7.3837 (0.7); 7.2985 (18.5);
7.1114 (1.8); 6.9294 (3.7); 6.7472 (1.8); 5.3373 (0.4); 4.5274 (1.8); 4.5069 (1.8); 4.4837 (3.8); 4.4632
(3.7); 4.4400 (1.9); 4.4195 (1.8); 1.5895 (16.0); 1.2934 (0.8); 0.1074 (1.1); 0.0481 (0.6); 0.0374
(16.7); 0.0265 (0.6)
I-457: ¹H-NMR(300.2 MHz, CDCl3):
δ = 7.3869 (3.5); 7.3603 (4.0); 7.2987 (17.6); 7.1030 (0.8); 7.0756 (6.5); 7.0582 (9.2); 7.0549 (9.0);
7.0470 (4.8); 7.0283 (1.7); 7.0199 (1.1); 6.9815 (2.4); 6.9548 (2.1); 6.8324 (0.4); 6.8194 (1.4); 6.8032
(2.1); 6.7974 (1.7); 6.7884 (2.2); 6.7738 (1.2); 6.7657 (1.1); 4.2658 (1.8); 4.2452 (1.8); 4.2170 (3.9);
4.1961 (4.2); 4.1712 (2.6); 4.1477 (3.6); 4.1241 (0.7); 3.0999 (11.5); 3.0817 (11.4); 2.5124 (11.8);
2.3208 (16.0); 2.1544 (0.4); 2.1373 (0.9); 2.1262 (1.0); 2.1090 (2.0); 2.0915 (1.3); 2.0830 (9.1);
2.0634 (0.6); 1.5946 (10.3); 1.3695 (0.4); 1.3450 (0.9); 1.3214 (3.6); 1.3054 (6.0); 1.2977 (8.7);
1.2738 (2.5); 1.0672 (1.3); 1.0517 (3.4); 1.0451 (3.8); 1.0304 (2.0); 1.0231 (3.7); 1.0166 (3.5); 1.0021
(1.7); 0.9809 (0.3); 0.9739 (0.4); 0.9427 (2.1); 0.9209 (6.5); 0.8976 (2.4); 0.8094 (1.7); 0.7944 (4.1);
0.7885 (4.2); 0.7775 (3.7); 0.7716 (4.5); 0.7555 (1.3); 0.0497 (0.7); 0.0389 (21.4); 0.0280 (0.9)
I-458: ¹H-NMR(400.1 MHz, d₆-DMSO):
δ = 9.1071 (1.9); 9.0923 (3.9); 9.0776 (1.9); 8.0896 (16.0); 7.7743 (1.4); 7.7543 (4.0); 7.7338 (3.8);
7.7043 (10.6); 7.6875 (2.8); 7.6277 (3.9); 7.6050 (8.5); 7.5845 (5.9); 7.5634 (7.0); 7.3633 (4.1);
7.3583 (4.0); 7.3423 (3.5); 7.3373 (3.3); 6.0886 (1.2); 6.0756 (2.2); 6.0634 (1.2); 5.9732 (1.2); 5.9603
(2.4); 5.9480 (1.2); 4.0507 (0.3); 4.0330 (0.3); 3.9354 (2.2); 3.9209 (3.3); 3.9100 (1.6); 3.9058 (1.6);
3.8779 (2.4); 3.8637 (3.7); 3.8503 (1.8); 3.3533 (0.5); 2.5228 (0.8); 2.5186 (1.1); 2.5145 (0.8); 1.9986
(1.3); 1.3769 (0.5); 1.2027 (0.3); 1.1849 (0.7); 1.1671 (0.3); −0.0002 (0.6)
I-459: ¹H-NMR(300.2 MHz, CDCl3):
δ = 8.3247 (0.3); 8.3040 (12.4); 7.9628 (1.3); 7.9453 (0.8); 7.4909 (1.8); 7.4640 (5.1); 7.4372 (4.1);
7.3985 (2.4); 7.3947 (3.3); 7.3924 (3.0); 7.3887 (2.8); 7.3719 (4.8); 7.3618 (1.5); 7.3456 (4.1); 7.3014
(22.8); 7.2686 (2.8); 7.2615 (5.0); 7.2548 (2.9); 7.1780 (2.2); 7.1743 (2.3); 7.1703 (2.1); 7.1668 (1.9);
7.1513 (1.9); 7.1475 (1.9); 7.1435 (1.8); 7.1399 (1.6); 7.0833 (4.0); 7.0039 (2.1); 6.9774 (1.8); 5.3411
(8.0); 4.2996 (2.0); 4.2798 (1.9); 4.2516 (4.3); 4.2318 (4.1); 4.2036 (2.2); 4.1838 (2.1); 2.5187 (6.5);
2.5117 (11.7); 2.5042 (6.4); 2.3726 (0.6); 2.3397 (16.0); 2.2488 (0.5); 1.5920 (11.5); 1.2958 (0.4);
0.0512 (0.9); 0.0404 (23.1); 0.0295 (0.8)
I-460: ¹H-NMR(400.1 MHz, CDCl3):
δ = 7.5017 (3.6); 7.4888 (3.4); 7.3994 (2.3); 7.3712 (1.0); 7.3648 (1.0); 7.3579 (1.2); 7.3530 (1.0);
7.3487 (0.8); 7.3425 (0.6); 7.2588 (6.2); 7.2422 (4.1); 7.1327 (3.6); 7.1129 (2.6); 6.5405 (0.9); 6.5207
(1.0); 5.3356 (0.8); 5.3174 (1.2); 5.2990 (0.8); 2.3700 (0.9); 2.3569 (16.0); 2.3213 (11.8); 2.2665
(0.4); 1.7984 (0.3); 1.5932 (6.9); 1.5759 (7.2); 1.5687 (6.5); −0.0002 (3.9)
I-461: ¹H-NMR(300.2 MHz, CDCl3):
δ = 8.5869 (8.4); 8.5853 (8.5); 7.9110 (1.4); 7.6659 (5.3); 7.6490 (6.5); 7.5096 (3.5); 7.4684 (1.4);
7.4602 (1.3); 7.4518 (1.8); 7.4469 (1.6); 7.4380 (1.2); 7.4299 (0.9); 7.3654 (3.4); 7.3388 (3.8); 7.3001
(12.6); 7.2985 (12.8); 7.0749 (4.0); 6.9880 (2.2); 6.9618 (1.9); 4.2992 (1.8); 4.2796 (1.7); 4.2512
(3.7); 4.2315 (3.6); 4.2030 (1.9); 4.1835 (1.8); 4.1722 (0.4); 2.5077 (11.5); 2.3192 (16.0); 2.0840
(1.3); 1.6293 (8.2); 1.3209 (0.4); 1.2968 (1.4); 1.2734 (0.4); 0.1089 (0.3); 0.0474 (0.8); 0.0391 (14.6);
0.0374 (14.3)
I-462: ¹H-NMR(400.1 MHz, CDCl3):
δ = 8.2471 (16.0); 8.0127 (0.8); 7.9325 (2.0); 7.4853 (1.4); 7.4719 (7.3); 7.4503 (13.2); 7.4278 (2.4);
7.3947 (10.7); 7.3734 (6.2); 7.2593 (26.6); 7.1017 (1.6); 7.0970 (1.7); 7.0772 (3.0); 7.0602 (1.4);
7.0552 (1.5); 7.0103 (2.8); 7.0053 (3.7); 6.9863 (7.0); 6.9837 (6.4); 6.9660 (2.6); 6.9602 (3.7); 6.9546
(1.7); 4.2103 (2.8); 4.1952 (2.7); 4.1747 (5.9); 4.1596 (5.8); 4.1391 (3.1); 4.1240 (3.0); 2.9528 (5.9);
2.8800 (5.5); 1.5457 (18.9); 1.2559 (0.5); −0.0002 (2.1)
I-463: ¹H-NMR(400.1 MHz, CDCl3):
δ = 8.6935 (4.7); 8.6890 (4.7); 8.5217 (4.5); 8.5158 (4.6); 8.2571 (10.3); 8.0142 (2.1); 7.8354 (3.0);
7.8303 (4.8); 7.8248 (2.9); 7.7851 (0.8); 7.7721 (1.3); 7.7582 (0.8); 7.5541 (3.7); 7.5328 (4.4); 7.4985
(3.7); 7.4947 (3.8); 7.3130 (2.3); 7.3084 (2.2); 7.2918 (2.0); 7.2872 (2.0); 7.2604 (21.7); 4.4368 (1.7);
4.4216 (1.7); 4.4001 (3.6); 4.3848 (3.5); 4.3634 (1.8); 4.3481 (1.8); 2.9551 (16.0); 2.8810 (14.8);
1.5570 (1.5); 0.0077 (1.4); −0.0002 (32.0); −0.0080 (1.3)
I-464: ¹H-NMR(400.1 MHz, CDCl3):
δ = 7.9987 (0.7); 7.5837 (1.5); 7.5683 (4.1); 7.5523 (0.4); 7.4319 (2.1); 7.3687 (0.7); 7.3619 (1.2);
7.3564 (0.9); 7.3434 (3.3); 7.3382 (3.2); 7.2851 (11.5); 7.2248 (2.1); 7.2043 (2.7); 7.0737 (1.7);
7.0684 (1.6); 7.0532 (1.3); 7.0480 (1.3); 6.1917 (0.5); 6.1769 (0.8); 6.1626 (0.5); 3.8640 (1.0); 3.8475
(2.8); 3.8315 (2.8); 3.8150 (1.1); 3.1202 (2.0); 3.1034 (3.8); 3.0866 (1.8); 2.9709 (5.1); 2.8866 (4.6);
2.4252 (16.0); 2.3182 (0.4); 1.5772 (6.4)
I-465: ¹H-NMR(400.1 MHz, d₆-DMSO):
δ = 9.1882 (0.9); 9.1727 (1.9); 9.1567 (1.0); 8.6193 (5.3); 8.3818 (2.9); 8.3698 (3.1); 8.1484 (6.2);
7.9605 (2.4); 7.8788 (3.5); 7.7922 (0.7); 7.7729 (2.0); 7.7534 (1.9); 7.7305 (2.6); 7.7084 (7.2); 7.6962
(3.4); 7.6274 (1.8); 7.6075 (1.5); 7.5109 (2.1); 7.4897 (3.3); 7.4176 (2.1); 7.3959 (1.4); 4.3336 (0.8);
4.3179 (0.9); 4.2996 (1.8); 4.2839 (1.8); 4.2652 (1.0); 4.2499 (0.9); 3.9992 (16.0); 3.3257 (106.7);
2.8986 (12.5); 2.7395 (11.9); 2.5094 (14.5)
I-466: ¹H-NMR(400.0 MHz, d₆-DMSO):
δ = 9.2959 (2.5); 9.2768 (2.6); 8.1978 (16.0); 7.9558 (1.6); 7.7605 (1.2); 7.7408 (3.8); 7.7211 (8.4);
7.6971 (4.4); 7.6774 (1.9); 7.6608 (6.2); 7.6558 (6.6); 7.6418 (3.2); 7.6212 (2.0); 7.5682 (6.3); 7.5579
(0.4); 7.5474 (8.3); 7.4188 (3.7); 7.4138 (3.7); 7.3979 (2.9); 7.3927 (2.9); 5.1686 (0.4); 5.1510 (1.8);
5.1328 (2.8); 5.1148 (1.9); 5.0969 (0.4); 3.3639 (29.5); 3.3540 (40.6); 3.3500 (42.5); 2.8937 (11.2);
2.7350 (9.6); 2.5296 (0.5); 2.5162 (11.7); 2.5118 (24.4); 2.5073 (32.6); 2.5027 (23.3); 2.4982 (11.2);
1.4557 (13.3); 1.4381 (13.2); 1.2392 (0.5); −0.0002 (0.8)
I-467: ¹H-NMR(400.1 MHz, CDCl3):
δ = 8.2490 (16.0); 7.8181 (2.2); 7.6198 (1.8); 7.6022 (3.2); 7.5847 (2.1); 7.4925 (1.8); 7.4777 (9.1);
7.4567 (13.6); 7.3932 (12.0); 7.3761 (7.1); 7.3723 (7.4); 7.3577 (1.8); 7.2591 (26.9); 7.0465 (3.1);
6.9099 (6.3); 6.7733 (3.1); 5.2970 (0.7); 4.2226 (2.9); 4.2073 (2.8); 4.1875 (6.1); 4.1722 (5.9); 4.1524
(3.1); 4.1371 (2.9); 2.7227 (0.7); 2.0016 (0.9); 1.5386 (31.9); 1.2549 (0.4); −0.0002 (18.2)
I-468: ¹H-NMR(300.2 MHz, CDCl3):
δ = 8.2846 (11.4); 8.1389 (1.3); 7.4130 (2.0); 7.3866 (4.5); 7.3688 (3.3); 7.3602 (3.0); 7.3424 (3.8);
7.2984 (34.0); 7.0898 (2.6); 7.0691 (4.6); 7.0266 (1.8); 7.0236 (1.8); 7.0186 (2.2); 7.0157 (2.0);
6.9997 (1.6); 6.9965 (1.7); 6.9885 (3.3); 6.9578 (1.8); 6.9427 (2.9); 6.9365 (3.7); 6.9296 (2.2); 5.3383
(16.0); 4.2876 (1.8); 4.2676 (1.7); 4.2394 (3.9); 4.2195 (3.7); 4.1913 (2.0); 4.1715 (1.9); 2.5102
(10.9); 2.5029 (6.0); 2.3295 (14.9); 2.0215 (0.4); 2.0045 (0.9); 1.9933 (1.0); 1.9766 (2.0); 1.9596
(1.1); 1.9485 (1.1); 1.9314 (0.5); 1.5813 (12.7); 1.0873 (1.3); 1.0720 (3.3); 1.0652 (3.6); 1.0501 (2.0);
1.0436 (3.6); 1.0372 (3.2); 1.0222 (1.6); 0.7992 (1.6); 0.7838 (4.2); 0.7780 (3.7); 0.7674 (3.4); 0.7617
(4.4); 0.7452 (1.2); 0.1077 (2.3); 0.0489 (1.4); 0.0382 (43.7); 0.0273 (1.6)
I-469: ¹H-NMR(499.9 MHz, CDCl3):
δ = 7.6202 (3.2); 7.5303 (3.4); 7.5205 (5.2); 7.4275 (2.8); 7.4132 (2.2); 7.3963 (3.1); 7.3337 (1.0);
7.3231 (3.3); 7.3066 (1.6); 7.2605 (3.6); 7.1900 (0.7); 7.1779 (1.3); 7.1659 (0.8); 4.3569 (1.0); 4.3441
(1.0); 4.3273 (2.1); 4.3146 (2.0); 4.2977 (1.1); 4.2850 (1.0); 4.1289 (0.8); 4.0306 (16.0); 4.0151 (0.5);
1.5819 (3.9); 1.3029 (0.3); 1.2891 (0.4); 1.2658 (1.2); 1.2564 (1.0); 0.8954 (0.7); 0.8818 (1.4); 0.8678
(0.7); −0.0002 (3.1)
I-470: ¹H-NMR(400.1 MHz, CDCl3):
δ = 8.2416 (16.0); 8.0138 (0.8); 7.8152 (1.8); 7.4793 (6.3); 7.4579 (10.4); 7.4276 (0.4); 7.4130 (0.3);
7.3948 (9.8); 7.3734 (5.9); 7.2592 (30.1); 7.2473 (0.4); 7.2404 (0.4); 7.2273 (3.7); 7.2182 (2.9);
7.2094 (7.6); 7.1952 (4.7); 7.1884 (2.4); 7.1734 (0.5); 7.1538 (0.4); 7.1439 (1.4); 7.1396 (1.5); 7.1311
(2.5); 7.1232 (2.4); 7.1150 (1.7); 7.1085 (1.3); 7.1035 (0.9); 7.0993 (0.8); 4.2221 (2.7); 4.2068 (2.6);
4.1871 (5.7); 4.1718 (5.5); 4.1520 (2.9); 4.1368 (2.8); 2.9531 (5.7); 2.8802 (5.2); 1.5434
(17.4); −0.0002 (2.5)
I-471: ¹H-NMR(400.1 MHz, CDCl3):
δ = 8.6944 (4.4); 8.6900 (4.3); 8.5206 (4.1); 8.5148 (4.2); 8.2566 (9.3); 8.0147 (2.2); 7.8349 (2.8);
7.8298 (4.5); 7.8243 (2.6); 7.7803 (0.8); 7.7669 (1.3); 7.7529 (0.8); 7.6522 (4.4); 7.4847 (0.7); 7.4627
(8.7); 7.4361 (0.5); 7.2604 (21.5); 4.4343 (1.5); 4.4189 (1.5); 4.3976 (3.3); 4.3823 (3.2); 4.3609 (1.7);
4.3455 (1.6); 2.9550 (16.0); 2.8811 (15.0); 1.5538 (2.4); −0.0002 (31.0)
I-472: ¹H-NMR(400.0 MHz, d₆-DMSO):
δ = 9.2048 (1.1); 9.1893 (2.4); 9.1734 (1.2); 8.0119 (11.9); 7.7528 (0.9); 7.7338 (2.8); 7.7140 (2.9);
7.7001 (3.5); 7.6801 (1.3); 7.6364 (8.0); 7.5665 (2.2); 7.5406 (4.6); 7.5197 (4.4); 7.2793 (2.2); 7.2624
(2.0); 7.2586 (2.0); 5.7564 (0.6); 5.4606 (5.1); 5.1917 (4.1); 4.3087 (1.1); 4.2930 (1.1); 4.2741 (2.4);
4.2580 (2.3); 4.2394 (1.2); 4.2230 (1.2); 3.3214 (175.2); 2.6748 (1.1); 2.6703 (1.5); 2.6659 (1.1);
2.5410 (0.6); 2.5238 (3.4); 2.5102 (94.9); 2.5059 (200.3); 2.5015 (270.2); 2.4970 (193.9); 2.4927
(92.4); 2.3328 (1.1); 2.3282 (1.5); 2.3235 (1.1); 2.0083 (16.0); 0.1459 (1.2); 0.0079 (8.7); −0.0002
(267.7); −0.0084 (9.7); −0.1499 (1.2)
I-473: ¹H-NMR(300.2 MHz, CDCl3):
δ = 8.9246 (5.4); 7.9720 (0.4); 7.9534 (0.7); 7.9343 (0.5); 7.6771 (1.4); 7.6565 (3.8); 7.6404 (0.4);
7.6358 (0.3); 7.5846 (2.3); 7.5551 (1.7); 7.4967 (0.7); 7.4873 (1.2); 7.4800 (0.9); 7.4740 (0.6); 7.4662
(0.8); 7.4587 (0.5); 7.4310 (0.4); 7.4030 (2.6); 7.3971 (3.4); 7.3936 (4.0); 7.3656 (0.5); 7.2983 (1.7);
6.1388 (0.5); 6.1283 (0.5); 6.1147 (0.6); 6.1041 (0.5); 5.9830 (0.5); 5.9725 (0.5); 5.9589 (0.6); 5.9484
(0.5); 4.3157 (0.3); 4.2342 (0.3); 4.2117 (0.3); 4.0969 (16.0); 3.8715 (0.3); 3.8644 (0.3); 3.8473 (0.3);
3.8191 (0.5); 3.8017 (0.4); 2.3986 (14.6); 1.6312 (0.7); 0.0341 (1.0)
I-474: ¹H-NMR(400.1 MHz, d₆-DMSO):
δ = 9.1412 (2.4); 9.1267 (5.1); 9.1122 (2.7); 7.9617 (2.2); 7.7587 (1.9); 7.7389 (5.8); 7.7193 (5.6);
7.7007 (7.0); 7.6815 (3.2); 7.6379 (8.1); 7.5805 (4.7); 7.5608 (3.8); 7.5164 (0.4); 7.4721 (8.2); 7.4511
(13.6); 7.3897 (14.6); 7.3688 (9.4); 5.8163 (1.4); 5.8049 (2.2); 5.7900 (1.6); 5.6985 (1.4); 5.6866
(2.2); 5.6719 (1.6); 3.9942 (0.4); 3.9470 (0.4); 3.9314 (0.8); 3.9107 (1.4); 3.8948 (2.8); 3.8867 (2.0);
3.8782 (2.9); 3.8603 (2.4); 3.8419 (2.8); 3.8269 (2.8); 3.8146 (2.2); 3.8021 (1.6); 3.7916 (0.7); 3.7777
(0.8); 3.7663 (0.5); 3.5693 (5.1); 3.5516 (12.1); 3.5342 (6.4); 3.4946 (0.4); 3.4278 (0.4); 3.3154
(46.2); 3.2539 (60.4); 3.2305 (1.5); 3.2027 (0.7); 3.0753 (0.4); 2.9741 (0.5); 2.9566 (1.0); 2.9409
(3.3); 2.9317 (3.7); 2.9242 (6.1); 2.9142 (6.3); 2.9068 (4.2); 2.8997 (16.0); 2.8819 (1.6); 2.8644 (0.7);
2.7408 (12.3); 2.5141 (27.2); 2.5098 (36.5); 2.5056 (27.6)
I-475: ¹H-NMR(400.1 MHz, d₆-DMSO):
δ = 9.1855 (1.0); 9.1697 (2.1); 9.1538 (1.1); 8.6183 (5.4); 8.3807 (2.9); 8.3687 (3.1); 8.1526 (5.1);
8.1501 (6.2); 7.9605 (2.4); 7.7899 (0.8); 7.7658 (4.6); 7.7512 (2.4); 7.7289 (3.0); 7.7074 (5.6); 7.6979
(6.2); 7.6257 (2.0); 7.6062 (1.7); 7.5854 (2.6); 7.5641 (2.9); 7.2806 (2.1); 7.2593 (1.9); 4.3389 (0.9);
4.3235 (1.0); 4.3051 (2.0); 4.2896 (2.0); 4.2712 (1.1); 4.2556 (1.0); 3.9968 (16.0); 3.3222 (117.4);
3.2733 (0.7); 2.8980 (11.4); 2.7390 (10.7); 2.5114 (14.6); 2.5081 (15.3)
I-476: ¹H-NMR(400.0 MHz, d₆-DMSO):
δ = 8.9914 (1.8); 8.1621 (5.0); 7.9542 (0.4); 7.7707 (0.4); 7.7510 (1.3); 7.7298 (1.7); 7.7235 (1.8);
7.6995 (1.4); 7.6799 (0.7); 7.6526 (1.0); 7.6333 (0.7); 7.5056 (1.5); 7.5004 (0.7); 7.4920 (1.7); 7.4834
(1.9); 7.4751 (0.8); 7.4699 (1.7); 7.0894 (1.7); 7.0843 (0.6); 7.0672 (3.3); 7.0502 (0.5); 7.0450 (1.6);
3.3800 (19.4); 3.3709 (33.2); 2.8929 (3.1); 2.7344 (2.7); 2.5158 (4.3); 2.5114 (9.0); 2.5069 (12.0);
2.5024 (8.6); 2.4979 (4.1); 1.6433 (16.0)
I-477: ¹H-NMR(300.2 MHz, CDCl3):
δ = 8.1240 (5.1); 7.9204 (0.7); 7.9006 (0.4); 7.6343 (0.5); 7.6108 (1.0); 7.5875 (2.7); 7.5587 (3.3);
7.5315 (0.4); 7.5070 (1.0); 7.5044 (1.0); 7.4830 (0.7); 7.4803 (0.7); 7.4537 (3.6); 7.4247 (3.2); 7.3957
(1.3); 7.3681 (0.5); 7.2985 (8.8); 7.1304 (1.0); 6.9480 (2.2); 6.7657 (1.0); 4.2756 (1.0); 4.2551 (1.0);
4.2290 (2.2); 4.2086 (2.1); 4.1825 (1.1); 4.1620 (1.1); 2.7620 (16.0); 1.5925 (4.5); 0.0376 (9.0);
0.0267 (0.3)
I-478: ¹H-NMR(300.2 MHz, CDCl3):
δ = 8.3043 (16.0); 7.9644 (1.1); 7.9464 (1.9); 7.9274 (1.1); 7.7295 (4.8); 7.7232 (5.2); 7.6907 (6.2);
7.6733 (9.8); 7.6474 (0.4); 7.5784 (5.4); 7.5498 (9.8); 7.4960 (0.4); 7.4828 (1.8); 7.4742 (1.7); 7.4684
(2.8); 7.4620 (2.3); 7.4524 (1.7); 7.4442 (1.2); 7.3570 (3.3); 7.3504 (3.2); 7.3288 (2.6); 7.3222 (2.6);
7.3016 (31.3); 4.5245 (2.7); 4.5041 (2.6); 4.4761 (5.6); 4.4556 (5.4); 4.4276 (2.8); 4.4073 (2.7);
2.0494 (1.6); 1.5900 (14.3); 1.2943 (0.8); 0.1101 (0.8); 0.0509 (1.0); 0.0400 (31.4); 0.0290 (1.1)
I-479: ¹H-NMR(400.0 MHz, d₆-DMSO):
δ = 9.2071 (1.6); 9.1912 (3.2); 9.1755 (1.6); 8.6209 (4.7); 8.6154 (4.8); 8.0734 (16.0); 8.0498 (2.9);
8.0435 (2.8); 8.0287 (3.0); 8.0224 (3.0); 7.7567 (1.2); 7.7374 (3.8); 7.7180 (3.8); 7.7033 (4.6); 7.6834
(1.8); 7.6336 (5.1); 7.5613 (3.0); 7.5414 (2.4); 7.5121 (5.0); 7.4912 (4.7); 4.2330 (1.5); 4.2175 (1.6);
4.1991 (3.5); 4.1833 (3.4); 4.1648 (1.8); 4.1488 (1.7); 3.3333 (129.7); 3.3294 (135.2); 2.6762 (0.4);
2.6713 (0.6); 2.6670 (0.5); 2.5418 (11.1); 2.5111 (41.1); 2.5069 (83.7); 2.5025 (111.8); 2.4981 (81.7);
2.3335 (0.4); 2.3292 (0.6); 2.3249 (0.5); −0.0007 (2.9)
I-480: ¹H-NMR(400.0 MHz, d₆-DMSO):
δ = 9.1570 (1.2); 9.1414 (2.5); 9.1258 (1.2); 7.9847 (12.9); 7.9601 (0.6); 7.5247 (1.8); 7.5049 (4.6);
7.4852 (3.5); 7.4352 (3.8); 7.4159 (2.4); 7.3516 (2.8); 7.3466 (4.4); 7.3428 (3.4); 7.3187 (6.0); 7.2987
(6.0); 7.0839 (4.3); 6.9439 (2.3); 6.9241 (2.1); 4.3170 (10.4); 4.1289 (1.2); 4.1133 (1.2); 4.0919 (2.7);
4.0762 (2.7); 4.0548 (1.4); 4.0391 (1.3); 3.3526 (15.5); 2.8977 (4.2); 2.7391 (3.7); 2.5316 (1.0);
2.5181 (17.8); 2.5139 (34.3); 2.5094 (44.4); 2.5049 (32.6); 2.4205 (11.3); 2.2627 (0.8); 2.2424 (16.0);
2.1938 (0.5)
I-481: ¹H-NMR(300.2 MHz, CDCl3):
δ = 8.2123 (5.2); 8.0553 (0.6); 8.0285 (0.6); 7.6067 (0.6); 7.5805 (1.6); 7.5542 (1.2); 7.4872 (1.4);
7.4615 (0.9); 7.4164 (1.8); 7.3905 (1.0); 7.3873 (1.1); 7.3834 (0.9); 7.3639 (0.7); 7.3605 (0.8); 7.3566
(0.8); 7.3053 (7.8); 6.8977 (1.1); 6.7100 (2.2); 6.6308 (4.8); 6.5223 (1.1); 5.4060 (0.6); 5.3815 (0.7);
5.3433 (1.7); 4.2006 (0.5); 4.1767 (1.6); 4.1529 (1.6); 4.1291 (0.5); 2.7790 (16.0); 2.6220 (1.4);
2.6084 (1.3); 2.3063 (0.6); 2.2923 (0.5); 2.2793 (0.4); 2.2624 (0.4); 2.0890 (7.3); 1.9604 (0.5); 1.9528
(0.5); 1.9334 (1.2); 1.9258 (1.2); 1.9173 (2.4); 1.9065 (1.4); 1.8970 (1.3); 1.8840 (0.4); 1.8729 (0.4);
1.6190 (2.7); 1.3268 (2.0); 1.3030 (4.3); 1.2792 (1.9); 0.0432 (7.6)
I-482: ¹H-NMR(400.1 MHz, CDCl3):
δ = 8.2501 (16.0); 8.0114 (1.5); 7.7839 (2.1); 7.4785 (6.0); 7.4570 (12.5); 7.4183 (11.9); 7.3969 (5.8);
7.2863 (2.3); 7.2818 (3.7); 7.2772 (2.7); 7.2594 (35.5); 7.2003 (6.1); 7.1977 (6.2); 6.9605 (2.3);
6.9552 (4.0); 6.9498 (2.3); 6.9388 (2.4); 6.9333 (4.0); 6.9280 (2.2); 4.2064 (2.9); 4.1913 (2.8); 4.1707
(6.0); 4.1555 (5.9); 4.1348 (3.1); 4.1197 (3.0); 2.9531 (10.7); 2.8796 (9.9); 1.5442 (26.6); −0.0002 (2.7)
I-483: ¹H-NMR(400.1 MHz, CDCl3):
δ = 8.6949 (4.5); 8.6906 (4.8); 8.5257 (4.4); 8.5199 (4.6); 8.2872 (10.0); 8.0175 (2.4); 7.8312 (2.9);
7.8259 (4.8); 7.8206 (3.0); 7.7825 (1.3); 7.5687 (4.7); 7.4334 (1.8); 7.4292 (1.7); 7.4125 (3.1); 7.4082
(3.1); 7.3581 (4.8); 7.3373 (2.8); 7.2602 (24.6); 6.0556 (0.9); 6.0478 (0.9); 6.0371 (1.0); 6.0294 (0.9);
5.9385 (0.9); 5.9309 (1.0); 5.9201 (1.0); 5.9124 (0.9); 4.3079 (0.4); 4.3005 (0.5); 4.2914 (0.5); 4.2834
(0.5); 4.2719 (0.6); 4.2638 (0.6); 4.2547 (0.6); 4.2470 (0.6); 4.2383 (0.5); 4.2306 (0.5); 4.2211 (0.5);
4.2131 (0.5); 4.2016 (0.6); 4.1939 (0.6); 4.1846 (0.6); 4.1767 (0.5); 3.8247 (0.6); 3.8119 (0.6); 3.8063
(0.6); 3.7935 (0.6); 3.7882 (0.5); 3.7744 (0.9); 3.7614 (0.7); 3.7561 (0.9); 3.7428 (0.6); 3.7374 (0.6);
3.7248 (0.5); 3.7187 (0.5); 3.7062 (0.4); 2.9567 (16.0); 2.8832 (14.8); 1.5570 (0.7); −0.0002 (36.1)
I-484: ¹H-NMR(400.1 MHz, d₆-DMSO):
δ = 8.6725 (0.7); 8.6589 (1.5); 8.6454 (0.7); 7.9618 (1.6); 7.7027 (0.7); 7.6829 (1.7); 7.6632 (1.3);
7.6254 (1.9); 7.6060 (1.0); 7.5094 (2.3); 7.4750 (1.3); 7.4552 (1.0); 7.0627 (1.8); 7.0576 (1.9); 6.9969
(2.1); 6.9763 (2.2); 6.4811 (2.5); 6.4754 (2.6); 6.1987 (1.4); 6.1928 (1.3); 6.1781 (1.3); 6.1723 (1.3);
3.7871 (0.8); 3.7474 (1.4); 3.7382 (14.1); 3.7143 (0.3); 3.6687 (16.0); 3.4225 (0.7); 3.4057 (1.7);
3.3910 (1.7); 3.3740 (0.8); 3.3159 (19.9); 2.8996 (10.3); 2.7406 (9.3); 2.6934 (1.4); 2.6757 (2.8);
2.6580 (1.6); 2.6397 (0.9); 2.6333 (0.9); 2.6259 (0.7); 2.5141 (8.9); 2.5098 (12.0); 2.5056 (9.1);
0.6570 (6.0); 0.6416 (2.9)
I-485: ¹H-NMR(300.2 MHz, CDCl3):
δ = 7.5074 (5.7); 7.4901 (7.4); 7.4643 (0.4); 7.4078 (3.8); 7.3780 (0.6); 7.3632 (4.8); 7.3490 (2.5);
7.3426 (2.6); 7.3358 (5.3); 7.2983 (22.5); 7.1836 (1.0); 7.1649 (1.8); 7.1450 (1.0); 7.0606 (4.2);
7.0180 (0.4); 6.9924 (2.3); 6.9650 (2.0); 6.7567 (0.6); 4.2129 (1.4); 4.1939 (1.7); 4.1707 (2.2); 4.1626
(3.2); 4.1467 (2.9); 4.1422 (3.1); 4.1232 (0.8); 4.1120 (1.6); 4.0915 (1.5); 3.5728 (1.4); 3.5511 (3.5);
3.5332 (3.6); 3.5117 (1.4); 2.5602 (2.8); 2.5378 (6.2); 2.5155 (3.5); 2.4850 (11.9); 2.3588 (0.3);
2.3228 (16.0); 2.1317 (0.5); 2.0838 (7.1); 2.0537 (2.8); 2.0316 (3.9); 2.0094 (2.5); 1.9870 (0.7);
1.4701 (5.1); 1.3208 (1.9); 1.2969 (4.1); 1.2787 (1.1); 1.2732 (1.9); 1.2594 (0.3); 0.1195 (1.3); 0.1078
(23.0); 0.0954 (0.9); 0.0483 (1.0); 0.0376 (22.2); 0.0267 (0.8)
I-486: ¹H-NMR(400.1 MHz, d₆-DMSO):
δ = 9.1408 (0.9); 9.1253 (2.0); 9.1100 (1.0); 8.6214 (5.2); 8.3849 (2.8); 8.3728 (3.1); 8.1920 (6.1);
7.9607 (1.9); 7.7911 (0.6); 7.7715 (2.0); 7.7513 (2.0); 7.7279 (5.7); 7.7153 (4.9); 7.7033 (3.6); 7.6406
(2.0); 7.6207 (1.6); 7.5862 (3.0); 7.5653 (5.8); 7.5227 (5.7); 7.5017 (3.2); 4.1879 (0.9); 4.1728 (1.0);
4.1535 (2.0); 4.1381 (2.0); 4.1197 (1.1); 4.1039 (1.0); 3.9992 (16.0); 3.3257 (97.6); 2.8985 (9.5);
2.7396 (9.1); 2.5092 (14.1)
I-487: ¹H-NMR(400.0 MHz, d₆-DMSO):
δ = 9.2896 (2.6); 9.2699 (2.7); 8.1889 (16.0); 8.1802 (0.7); 7.9544 (0.4); 7.7592 (1.2); 7.7396 (3.9);
7.7262 (5.5); 7.7206 (6.7); 7.6952 (4.4); 7.6765 (2.0); 7.6447 (3.1); 7.6264 (2.0); 7.6241 (2.0); 7.4741
(5.9); 7.3818 (2.2); 7.3628 (4.8); 7.3440 (3.4); 7.3248 (6.4); 7.3060 (3.5); 7.2901 (3.0); 7.2857 (4.6);
7.2814 (3.1); 7.2707 (1.6); 7.2662 (2.2); 7.2622 (1.4); 5.1752 (0.4); 5.1576 (1.8); 5.1393 (2.7); 5.1212
(1.9); 5.1033 (0.5); 3.4449 (0.3); 3.3975 (70.7); 3.3893 (111.8); 2.8932 (2.5); 2.7348 (2.2); 2.5307
(0.4); 2.5174 (10.1); 2.5130 (21.5); 2.5085 (29.3); 2.5039 (21.3); 2.4995 (10.4); 1.4602 (13.6); 1.4427
(13.7); 1.4263 (0.6); 1.2391 (0.4)
I-488: ¹H-NMR(400.1 MHz, d₆-DMSO):
δ = 8.7980 (0.9); 8.7844 (1.7); 8.7708 (0.9); 8.5666 (8.1); 7.9589 (0.5); 7.8006 (0.6); 7.7805 (1.9);
7.7601 (3.5); 7.7519 (5.6); 7.6636 (1.8); 7.6453 (1.3); 7.0555 (2.6); 7.0364 (2.9); 6.9122 (3.5); 6.7717
(1.9); 6.7530 (1.6); 3.5247 (1.2); 3.5078 (2.6); 3.4914 (2.6); 3.4744 (1.2); 3.3195 (19.3); 2.8967 (2.9);
2.8290 (2.2); 2.8110 (3.7); 2.7931 (1.9); 2.7376 (2.6); 2.6762 (0.4); 2.5112 (54.3); 2.5071 (68.3);
2.5031 (50.0); 2.3338 (0.4); 2.2624 (16.0); 2.1605 (14.5)
I-489: ¹H-NMR(300.2 MHz, CDCl3):
δ = 8.3336 (10.0); 7.7350 (1.0); 7.6500 (0.6); 7.6309 (6.1); 7.6088 (2.6); 7.5826 (0.7); 7.3376 (2.9);
7.3039 (9.0); 7.2957 (1.7); 7.2794 (1.3); 7.2722 (1.8); 7.2643 (0.8); 7.2085 (2.0); 7.1832 (2.1); 7.0314
(0.9); 7.0269 (0.9); 7.0055 (1.9); 7.0030 (2.0); 6.9802 (1.3); 6.9754 (1.2); 6.7923 (1.5); 6.7884 (1.7);
6.7674 (2.3); 6.7636 (2.8); 6.7488 (3.2); 6.7451 (2.8); 6.7388 (1.4); 6.7217 (2.4); 5.3413 (1.1); 4.3261
(0.6); 4.3148 (0.7); 4.3012 (0.6); 4.2892 (1.8); 4.2775 (1.4); 4.2640 (1.5); 4.2526 (1.3); 4.2316 (1.2);
4.2201 (1.4); 4.2074 (1.4); 4.1969 (2.6); 4.1828 (0.7); 4.1737 (3.8); 4.1585 (0.7); 4.1499 (3.6); 4.1261
(1.2); 4.0446 (0.6); 4.0292 (0.7); 4.0221 (0.6); 4.0065 (0.7); 3.9985 (1.4); 3.9831 (1.5); 3.9761 (1.4);
3.9607 (1.4); 3.9324 (1.3); 3.9151 (1.6); 3.9111 (1.6); 3.8939 (1.4); 3.8865 (0.7); 3.8691 (0.7); 3.8649
(0.7); 3.8479 (0.6); 3.3303 (0.3); 3.3097 (1.0); 3.2908 (1.3); 3.2722 (1.0); 2.2192 (0.4); 2.2079 (0.4);
2.1985 (0.5); 2.1944 (0.5); 2.1872 (0.6); 2.1831 (0.5); 2.1730 (0.9); 2.1613 (1.0); 2.1516 (0.8); 2.1477
(0.9); 2.1402 (0.9); 2.1364 (0.8); 2.1272 (0.7); 2.1156 (0.6); 2.0866 (16.0); 2.0457 (0.7); 2.0336 (0.7);
2.0218 (1.1); 2.0105 (1.1); 1.9985 (1.0); 1.9871 (0.9); 1.9750 (0.7); 1.9639 (0.6); 1.9515 (0.4); 1.9401
(0.3); 1.6266 (7.4); 1.3247 (4.3); 1.3008 (8.4); 1.2770 (4.1); 0.0416 (7.6)
I-490: ¹H-NMR(400.0 MHz, d₆-DMSO):
δ = 9.1801 (1.2); 9.1651 (2.5); 9.1499 (1.2); 8.0103 (9.3); 7.6531 (1.5); 7.6308 (3.1); 7.6109 (1.8);
7.3524 (2.5); 7.3331 (7.3); 7.3022 (5.7); 7.0811 (4.5); 6.9301 (2.5); 6.9107 (2.2); 4.1317 (1.2); 4.1160
(1.2); 4.0946 (2.7); 4.0790 (2.6); 4.0575 (1.4); 4.0418 (1.3); 3.3398 (40.2); 2.6785 (0.3); 2.5094
(57.7); 2.4193 (11.7); 2.3360 (0.4); 2.2609 (0.6); 2.2272 (16.0); 2.1805 (0.5)
I-491: ¹H-NMR(400.1 MHz, CDCl3):
δ = 8.2404 (16.0); 8.0148 (1.2); 7.7574 (2.1); 7.6479 (7.2); 7.4703 (1.3); 7.4491 (12.8); 7.4212 (1.0);
7.2902 (2.2); 7.2853 (3.5); 7.2808 (2.6); 7.2587 (46.6); 7.2069 (5.8); 7.2049 (5.7); 6.9664 (2.2);
6.9611 (3.9); 6.9557 (2.2); 6.9447 (2.3); 6.9393 (3.9); 6.9339 (2.1); 4.4257 (2.6); 4.4104 (2.5); 4.3894
(5.4); 4.3741 (5.3); 4.3531 (2.8); 4.3378 (2.7); 2.9534 (8.1); 2.8807 (7.4); 1.5340 (47.6); 1.5033 (0.3);
1.2556 (0.4)
I-492: ¹H-NMR(400.1 MHz, CDCl3):
δ = 8.2444 (16.0); 8.0130 (1.7); 7.8728 (2.1); 7.4803 (6.2); 7.4587 (12.6); 7.4481 (4.7); 7.4413 (4.2);
7.4342 (4.1); 7.4146 (11.3); 7.3932 (5.9); 7.2594 (35.4); 7.2411 (5.4); 7.2214 (4.6); 7.1653 (2.5);
7.1561 (3.5); 7.1485 (2.6); 7.1430 (1.8); 7.1339 (2.1); 7.1261 (1.5); 4.2097 (2.8); 4.1946 (2.8); 4.1739
(5.9); 4.1588 (5.8); 4.1380 (3.0); 4.1229 (2.9); 2.9533 (12.2); 2.8802 (11.3); 1.5445 (26.1); −0.0002 (2.9)
I-493: ¹H-NMR(400.1 MHz, d₆-DMSO):
δ = 9.0048 (1.3); 8.9907 (2.7); 8.9763 (1.3); 7.9618 (2.6); 7.6958 (1.1); 7.6761 (3.1); 7.6562 (2.4);
7.6214 (3.2); 7.6019 (1.7); 7.5150 (0.7); 7.4781 (4.2); 7.4558 (2.5); 7.4273 (5.0); 7.4058 (6.4); 7.3217
(6.8); 7.3009 (4.7); 7.1240 (3.3); 7.1192 (3.4); 5.7366 (0.7); 5.7228 (1.5); 5.7082 (0.7); 5.6187 (0.7);
5.6043 (1.6); 5.5904 (0.8); 3.7916 (1.2); 3.7776 (2.2); 3.7635 (1.2); 3.7369 (1.3); 3.7230 (2.2); 3.7085
(1.3); 3.3156 (26.0); 2.8995 (16.0); 2.7404 (14.5); 2.6547 (1.2); 2.6460 (1.4); 2.6399 (1.5); 2.6321
(1.2); 2.5140 (14.8); 2.5097 (19.9); 2.5055 (15.0); 0.6871 (4.0); 0.6694 (7.1)
I-494: ¹H-NMR(499.9 MHz, d₆-DMSO):
δ = 9.1929 (0.4); 9.1816 (0.7); 9.1699 (0.4); 8.8543 (3.5); 8.7183 (1.4); 8.7085 (1.5); 8.2587 (0.4);
8.2392 (3.3); 8.1117 (0.4); 7.9562 (2.3); 7.7545 (1.8); 7.7365 (1.3); 7.7267 (1.2); 7.5402 (0.3); 7.5371
(0.3); 7.5234 (1.3); 7.5204 (1.5); 7.5125 (1.8); 7.4953 (0.8); 7.4759 (0.6); 7.3850 (0.5); 7.3743 (0.5);
7.3707 (0.5); 7.3583 (0.8); 7.3539 (0.9); 7.3446 (0.8); 7.3277 (0.4); 6.0682 (0.4); 6.0654 (0.3); 5.9762
(0.4); 5.9733 (0.4); 3.9087 (0.3); 3.8965 (0.4); 3.3268 (9.5); 2.8933 (16.0); 2.7346 (14.1); 2.5125
(0.8); 2.5091 (1.7); 2.5056 (2.3); 2.5020 (1.7); 2.4986 (0.8); −0.0002 (0.9)
I-495: ¹H-NMR(400.0 MHz, d₆-DMSO):
δ = 9.2159 (3.0); 9.1962 (3.1); 8.1712 (16.0); 7.9550 (0.6); 7.7542 (1.3); 7.7348 (3.8); 7.7144 (3.4);
7.6887 (11.2); 7.6698 (2.4); 7.6276 (3.7); 7.6080 (2.3); 7.4609 (4.5); 7.4470 (5.2); 7.4393 (5.8);
7.4306 (2.3); 7.4254 (5.1); 7.1400 (0.6); 7.1323 (5.9); 7.1273 (2.1); 7.1155 (2.3); 7.1101 (10.8);
7.0930 (1.8); 7.0879 (5.4); 7.0803 (0.6); 5.1669 (0.5); 5.1495 (1.9); 5.1313 (2.9); 5.1131 (2.0); 5.0956
(0.5); 3.3675 (39.2); 3.3641 (48.1); 3.3607 (48.9); 3.3574 (53.6); 2.8926 (4.1); 2.7343 (3.6); 2.5290
(0.4); 2.5155 (10.8); 2.5112 (22.9); 2.5066 (31.0); 2.5021 (22.5); 2.4977 (11.0); 1.4550 (15.0); 1.4376
(14.8); 1.2395 (0.4); −0.0002 (0.7)
I-496: ¹H-NMR(400.2 MHz, d₆-DMSO):
δ = 9.1703 (1.1); 9.1548 (2.4); 9.1391 (1.1); 8.3165 (0.4); 8.0126 (14.8); 7.7672 (1.0); 7.7477 (2.9);
7.7281 (2.8); 7.7114 (3.3); 7.6916 (1.3); 7.6269 (3.8); 7.5676 (2.1); 7.5474 (1.7); 7.4327 (4.0); 7.4126
(4.4); 7.3834 (4.4); 6.9681 (2.3); 6.9482 (2.1); 4.2831 (1.2); 4.2672 (1.2); 4.2479 (2.6); 4.2321 (2.5);
4.2126 (1.3); 4.1969 (1.2); 3.9028 (3.2); 3.3260 (105.2); 2.6755 (0.9); 2.6709 (1.2); 2.6664 (0.9);
2.6618 (0.4); 2.5244 (3.9); 2.5196 (6.2); 2.5110 (79.8); 2.5065 (160.3); 2.5020 (207.7); 2.4974
(147.9); 2.4929 (70.5); 2.3470 (0.4); 2.3379 (0.5); 2.3333 (1.0); 2.3288 (1.3); 2.3242 (0.9); 2.2170
(16.0); −0.0003 (1.1)
I-497: ¹H-NMR(499.9 MHz, d₆-DMSO):
δ = 9.3020 (0.8); 9.2896 (1.5); 9.2771 (0.7); 7.7396 (0.7); 7.7238 (1.8); 7.7079 (1.4); 7.6808 (1.8);
7.6651 (1.0); 7.5882 (2.3); 7.5551 (1.3); 7.5393 (1.0); 7.3227 (2.2); 7.3067 (2.3); 7.0951 (2.4); 6.9683
(1.3); 6.9525 (1.2); 4.1651 (0.7); 4.1526 (0.7); 4.1352 (1.5); 4.1227 (1.4); 4.1052 (0.8); 4.0927 (0.7);
3.3213 (3.0); 2.5091 (0.7); 2.5056 (1.3); 2.5020 (1.6); 2.4984 (1.1); 2.4949 (0.5); 2.4323 (6.7); 2.2390
(9.3); 2.2090 (16.0); 0.8563 (0.5)
I-498: ¹H-NMR(300.2 MHz, CDCl3):
δ = 8.3129 (16.0); 7.9627 (1.7); 7.6825 (6.5); 7.6650 (8.6); 7.5152 (4.6); 7.5002 (0.6); 7.4865 (2.0);
7.4767 (2.4); 7.4709 (2.9); 7.4641 (2.4); 7.4542 (2.6); 7.4493 (3.1); 7.4318 (2.3); 7.4234 (1.8); 7.4054
(1.8); 7.3681 (4.0); 7.3408 (2.1); 7.3037 (11.0); 7.2918 (2.5); 7.2620 (2.3); 7.2153 (1.3); 7.2081 (1.2);
7.1873 (2.2); 7.1806 (1.9); 7.1599 (1.0); 7.1533 (0.9); 4.2849 (2.7); 4.2647 (2.6); 4.2374 (5.6); 4.2171
(5.5); 4.1898 (2.9); 4.1696 (2.8); 4.1493 (0.5); 2.0860 (2.2); 1.6137 (6.3); 1.3243 (0.7); 1.3004 (1.8);
1.2766 (0.7); 0.0415 (9.8); 0.0307 (0.4)
I-499: ¹H-NMR(300.2 MHz, CDCl3):
δ = 8.9369 (4.0); 8.8035 (3.6); 8.7952 (3.5); 8.3414 (11.1); 7.9213 (3.6); 7.7807 (1.4); 7.3856 (3.4);
7.3590 (4.0); 7.3047 (22.4); 7.0970 (4.0); 7.0230 (2.2); 6.9969 (1.9); 4.3232 (1.9); 4.3036 (1.9);
4.2748 (4.1); 4.2551 (3.9); 4.2263 (2.1); 4.2066 (2.0); 2.5193 (11.7); 2.5122 (6.5); 2.3387 (16.0);
1.6014 (10.8); 1.2990 (0.4); 0.1134 (0.7); 0.0539 (1.0); 0.0433 (21.9); 0.0324 (0.8)
I-500: ¹H-NMR(400.1 MHz, d₆-DMSO):
δ = 8.7914 (0.7); 8.7773 (1.4); 8.7630 (0.7); 7.9620 (0.7); 7.7530 (0.6); 7.7333 (1.6); 7.7136 (1.5);
7.6917 (1.9); 7.6720 (0.9); 7.6089 (2.2); 7.5645 (1.3); 7.5448 (1.1); 7.0344 (2.1); 7.0138 (2.3); 6.5184
(2.4); 6.5127 (2.6); 6.2915 (1.4); 6.2856 (1.4); 6.2709 (1.4); 6.2650 (1.3); 3.7695 (14.2); 3.7244 (0.4);
3.6845 (16.0); 3.5142 (0.8); 3.4974 (2.1); 3.4821 (2.2); 3.4658 (0.9); 3.3157 (13.2); 2.8998 (4.4);
2.7479 (1.6); 2.7409 (4.6); 2.7311 (3.1); 2.7141 (1.5); 2.5142 (7.1); 2.5099 (9.6); 2.5057 (7.2); 2.4809
(0.5); 2.2778 (13.1)
I-501: ¹H-NMR(400.1 MHz, d₆-DMSO):
δ = 9.1974 (1.3); 9.1837 (2.6); 9.1693 (1.5); 8.8607 (7.0); 8.7244 (3.7); 8.7121 (4.0); 8.2447 (7.8);
8.1165 (0.7); 7.9609 (3.4); 7.7412 (3.7); 7.7290 (3.8); 7.6499 (5.1); 7.5965 (3.0); 7.5755 (3.9); 7.5189
(0.6); 7.4992 (1.5); 7.4801 (1.8); 7.4570 (1.0); 7.4182 (3.2); 7.3970 (3.3); 7.3762 (2.0); 7.3580 (3.5);
7.3446 (2.4); 7.3250 (1.0); 6.1072 (0.7); 6.0946 (1.3); 6.0828 (0.9); 5.9919 (0.8); 5.9795 (1.3); 5.9679
(0.9); 3.9981 (0.4); 3.9773 (0.6); 3.9609 (1.1); 3.9425 (0.9); 3.9205 (1.3); 3.9061 (1.9); 3.8623 (0.9);
3.8511 (1.2); 3.8394 (0.8); 3.8289 (0.5); 3.8159 (0.5); 3.8038 (0.4); 3.3256 (135.8); 2.8996 (16.0);
2.7404 (15.0); 2.5105 (20.0); 2.5073 (18.7)
I-502: ¹H-NMR(400.0 MHz, d₆-DMSO):
δ = 9.1981 (0.9); 9.1783 (0.9); 8.1645 (5.1); 7.9534 (0.3); 7.7531 (0.4); 7.7335 (1.4); 7.7145 (2.8);
7.6915 (1.7); 7.6723 (0.7); 7.6370 (1.1); 7.6174 (0.7); 7.2243 (1.1); 7.2042 (2.3); 7.1838 (1.4); 6.9792
(1.6); 6.9749 (1.6); 6.9694 (2.0); 6.9641 (2.6); 6.8030 (1.0); 6.7981 (1.0); 6.7822 (0.9); 6.7781 (0.9);
5.1263 (0.7); 5.1079 (1.0); 5.0895 (0.7); 3.6584 (16.0); 3.3715 (17.3); 3.3659 (24.3); 3.3634 (24.2);
3.3617 (24.2); 2.8917 (2.2); 2.7337 (2.0); 2.5142 (4.3); 2.5099 (8.9); 2.5054 (11.9); 2.5009 (8.6);
2.4965 (4.2); 1.4519 (5.0); 1.4344 (5.0)
I-503: ¹H-NMR(300.2 MHz, CDCl3):
δ = 7.5659 (3.1); 7.3904 (0.8); 7.3627 (5.0); 7.3562 (3.9); 7.3510 (3.3); 7.3281 (0.6); 7.3228 (0.6);
7.3051 (1.5); 7.2983 (2.8); 7.2791 (2.6); 7.2527 (1.8); 6.9645 (2.2); 6.9574 (3.6); 6.9303 (3.5); 6.8971
(2.9); 6.8912 (3.5); 6.8849 (2.1); 6.8750 (1.4); 6.8550 (0.8); 6.0437 (0.6); 6.0333 (0.7); 6.0210 (0.7);
6.0106 (0.6); 5.8886 (0.6); 5.8782 (0.7); 5.8659 (0.7); 5.8555 (0.6); 4.1321 (0.4); 4.1215 (0.4); 4.1107
(0.4); 4.0999 (0.5); 4.0932 (0.4); 4.0714 (0.3); 4.0440 (0.4); 4.0334 (0.4); 4.0226 (0.4); 4.0121 (0.4);
3.9071 (0.4); 3.8863 (0.6); 3.8645 (0.4); 3.8587 (0.4); 3.8337 (0.6); 3.8124 (0.7); 3.7897 (0.4); 3.7835
(0.4); 3.7615 (0.5); 3.7407 (0.3); 2.5980 (0.4); 2.5751 (15.8); 2.5617 (1.1); 2.3797 (0.5); 2.2629
(16.0); 2.0295 (4.0); 1.9531 (0.4); 1.9361 (0.7); 1.9250 (0.8); 1.9083 (1.4); 1.8915 (0.8); 1.8804 (0.8);
1.8634 (0.4); 1.0116 (0.9); 0.9963 (2.4); 0.9896 (2.6); 0.9749 (1.5); 0.9681 (2.6); 0.9615 (2.2); 0.9471
(1.0); 0.7379 (1.2); 0.7227 (3.0); 0.7171 (2.8); 0.7065 (2.6); 0.7007 (3.0); 0.6845 (0.8); 0.0358 (2.0)
I-504: ¹H-NMR(400.1 MHz, d₆-DMSO):
δ = 8.9788 (1.7); 8.9584 (1.7); 7.9601 (1.8); 7.7140 (6.1); 7.6761 (2.1); 7.6563 (2.3); 7.4013 (2.1);
7.3808 (2.5); 7.3113 (4.8); 7.1625 (0.5); 7.1492 (1.4); 7.1420 (3.1); 7.1287 (4.7); 7.1184 (2.0); 7.1133
(1.7); 7.1038 (0.6); 6.9520 (1.3); 6.9332 (2.2); 6.9153 (1.5); 6.9068 (1.3); 6.8960 (1.3); 6.8843 (0.9);
6.8785 (0.7); 5.4782 (0.9); 5.4599 (1.3); 5.4420 (0.9); 3.7363 (16.0); 3.3400 (90.0); 2.8973 (10.7);
2.7385 (9.8); 2.5741 (15.0); 2.5131 (7.2); 2.5092 (9.5); 2.5052 (7.4); 2.0746 (0.6); 2.0661 (0.7);
2.0540 (1.2); 2.0410 (0.8); 2.0331 (0.7); 2.0197 (0.4); 1.6137 (6.1); 1.5967 (6.3); 1.0373 (0.7); 1.0264
(2.2); 1.0212 (2.4); 1.0108 (1.4); 1.0054 (2.3); 1.0003 (2.4); 0.9903 (1.0); 0.7916 (0.9); 0.7771 (2.7);
0.7686 (2.6); 0.7641 (2.7); 0.7527 (0.9)
I-505: ¹H-NMR(400.2 MHz, d₆-DMSO):
δ = 9.2349 (1.4); 9.2192 (2.8); 9.2036 (1.4); 8.3161 (0.3); 8.0260 (16.0); 8.0169 (0.3); 7.7608 (1.2);
7.7412 (3.5); 7.7217 (3.5); 7.7051 (6.0); 7.6861 (1.8); 7.6774 (2.6); 7.6740 (2.6); 7.6248 (4.7); 7.5534
(2.6); 7.5334 (2.1); 7.4596 (2.0); 7.4390 (4.2); 7.4185 (2.6); 7.2904 (3.0); 7.2866 (2.9); 7.2697 (2.3);
7.2656 (2.3); 4.1990 (1.3); 4.1834 (1.4); 4.1643 (2.9); 4.1484 (2.8); 4.1294 (1.5); 4.1135 (1.4); 3.9030
(3.7); 3.3300 (213.6); 2.6805 (0.4); 2.6761 (0.9); 2.6715 (1.3); 2.6669 (0.9); 2.6625 (0.4); 2.5250
(4.0); 2.5202 (6.2); 2.5116 (80.6); 2.5071 (163.5); 2.5026 (213.5); 2.4980 (152.7); 2.4935 (73.6);
2.3384 (0.4); 2.3339 (0.9); 2.3294 (1.3); 2.3248 (1.0); 2.3203 (0.4); −0.0002 (1.0)
I-506: ¹H-NMR(499.9 MHz, CDCl3):
δ = 7.5518 (0.3); 7.5356 (2.1); 7.5238 (5.2); 7.3969 (2.5); 7.3413 (0.8); 7.3356 (1.2); 7.3306 (1.2);
7.3236 (1.0); 7.2586 (4.2); 7.0119 (2.1); 6.9966 (2.5); 6.9514 (3.0); 6.8406 (1.6); 6.8254 (1.4); 6.1293
(0.6); 6.1185 (1.1); 6.1077 (0.6); 5.2955 (1.5); 3.7717 (1.2); 3.7588 (3.2); 3.7458 (3.4); 3.7327 (1.3);
2.9355 (2.2); 2.9219 (4.2); 2.9083 (2.0); 2.3853 (16.0); 2.2872 (14.4); 2.2696 (0.6); 2.2426 (13.3);
2.1584 (0.5); 1.5656 (9.3); −0.0002 (2.9)
I-507: ¹H-NMR(300.2 MHz, CDCl3):
δ = 8.5670 (7.6); 8.0400 (0.7); 8.0206 (1.2); 8.0007 (0.7); 7.8052 (0.7); 7.7374 (2.9); 7.7211 (0.6);
7.6937 (2.0); 7.6726 (5.5); 7.6513 (0.5); 7.5500 (2.6); 7.5331 (0.4); 7.5157 (1.1); 7.5062 (1.7); 7.4989
(1.1); 7.4919 (0.7); 7.4855 (1.2); 7.4774 (0.7); 7.4158 (0.4); 7.3846 (2.7); 7.3579 (3.0); 7.3035 (17.2);
7.0835 (2.8); 6.9927 (1.5); 6.9656 (1.3); 4.3313 (1.2); 4.3116 (1.2); 4.2832 (2.5); 4.2633 (2.4); 4.2350
(1.2); 4.2150 (1.2); 4.1981 (0.7); 4.1743 (1.9); 4.1505 (1.9); 4.1267 (0.7); 4.0874 (16.0); 3.9228 (0.5);
3.9088 (0.8); 2.9986 (1.1); 2.9251 (1.0); 2.6573 (1.3); 2.6347 (0.8); 2.5285 (8.2); 2.3223 (11.3);
2.0868 (8.6); 1.8682 (0.3); 1.7797 (0.6); 1.7681 (0.7); 1.7439 (0.7); 1.7202 (0.8); 1.4553 (0.6); 1.4345
(0.6); 1.3242 (2.6); 1.3004 (5.3); 1.2829 (6.5); 1.2767 (2.8); 0.0512 (0.4); 0.0404 (15.4); 0.0295 (0.6)
I-508: ¹H-NMR(400.1 MHz, CDCl3):
δ = 8.5877 (5.0); 8.5830 (4.9); 8.4556 (4.8); 8.4499 (4.8); 8.2790 (11.1); 7.7476 (1.4); 7.6595 (3.3);
7.6539 (5.3); 7.6485 (3.1); 7.3357 (3.4); 7.3158 (3.8); 7.2599 (19.9); 7.0516 (4.1); 6.9806 (2.2);
6.9605 (2.0); 4.2551 (1.8); 4.2404 (1.8); 4.2190 (3.8); 4.2042 (3.7); 4.1827 (1.9); 4.1680 (1.8); 2.4724
(11.8); 2.3047 (16.0); 2.0042 (0.3); 1.5535 (6.8); −0.0002 (19.3)
I-509: ¹H-NMR(300.2 MHz, CDCl3):
δ = 8.8818 (5.6); 7.9452 (0.4); 7.9257 (0.7); 7.9054 (0.4); 7.6876 (1.5); 7.6744 (2.9); 7.6692 (4.5);
7.6658 (3.5); 7.6547 (0.4); 7.6511 (0.4); 7.5432 (1.5); 7.5155 (1.2); 7.4998 (0.4); 7.4871 (3.3); 7.4734
(1.1); 7.4667 (1.1); 7.4557 (2.2); 7.4502 (1.8); 7.4278 (0.7); 7.4219 (0.6); 7.2982 (6.3); 5.3358 (1.1);
4.5093 (0.8); 4.4889 (0.8); 4.4610 (1.8); 4.4405 (1.7); 4.4127 (0.9); 4.3922 (0.9); 4.0953 (0.6); 3.9770
(16.0); 2.4095 (15.3); 2.3940 (0.7); 2.0420 (0.3); 1.5970 (3.9); 0.0366 (4.7)
I-510: ¹H-NMR(400.1 MHz, d₆-DMSO):
δ = 9.1034 (0.8); 9.0888 (1.7); 9.0741 (0.9); 7.9619 (1.0); 7.7522 (0.7); 7.7326 (2.0); 7.7129 (1.9);
7.6913 (2.4); 7.6721 (1.2); 7.5939 (2.8); 7.5558 (1.6); 7.5363 (1.3); 7.4697 (2.6); 7.4485 (5.1); 7.4081
(5.6); 7.3869 (3.0); 5.8377 (0.5); 5.8258 (0.8); 5.8116 (0.6); 5.7200 (0.5); 5.7083 (0.8); 5.6935 (0.6);
3.9145 (0.5); 3.8984 (0.9); 3.8821 (0.7); 3.8722 (0.5); 3.8604 (1.1); 3.8458 (1.2); 3.8288 (0.6); 3.8132
(0.6); 3.8007 (0.7); 3.7889 (0.5); 3.3155 (14.5); 2.8997 (6.0); 2.7407 (5.4); 2.5141 (8.3); 2.5099
(11.3); 2.5057 (8.7); 2.4648 (0.5); 2.2543 (16.0)
I-511: ¹H-NMR(400.1 MHz, CDCl3):
δ = 8.6420 (0.7); 8.1529 (4.9); 7.8786 (2.0); 7.8716 (2.1); 7.6431 (2.1); 7.6214 (2.4); 7.5813 (2.2);
7.5686 (3.8); 7.4054 (2.2); 7.3917 (0.9); 7.3816 (1.1); 7.3769 (1.0); 7.3692 (0.8); 7.3630 (0.5); 7.2600
(10.8); 7.2442 (1.4); 7.2370 (1.3); 7.2224 (1.2); 7.2153 (1.2); 4.4585 (0.9); 4.4434 (0.9); 4.4262 (2.0);
4.4112 (1.9); 4.3939 (1.0); 4.3789 (1.0); 3.7548 (16.0); 2.9551 (1.8); 2.8827 (1.8); 2.7191 (14.5);
2.6861 (0.5); 1.5640 (1.3); 1.2613 (0.4); 1.2446 (0.3); 0.0078 (0.5); −0.0002 (13.4)
I-512: ¹H-NMR(400.1 MHz, d₆-DMSO):
δ = 9.3361 (2.0); 9.3206 (4.4); 9.3044 (2.6); 8.8534 (13.9); 8.7175 (7.4); 8.7051 (8.0); 8.1502 (16.0);
8.0531 (1.7); 7.9607 (2.4); 7.8742 (7.7); 7.7199 (7.1); 7.7076 (7.2); 7.5408 (4.8); 7.5197 (8.7); 7.5038
(3.4); 7.4801 (2.7); 7.4574 (6.3); 7.4365 (3.9); 7.4148 (1.6); 7.3946 (2.5); 7.3900 (2.4); 7.3752 (2.8);
7.3577 (1.6); 7.3175 (2.6); 7.3008 (3.3); 7.2803 (1.8); 7.2412 (0.4); 7.2210 (0.5); 4.3369 (1.7); 4.3206
(2.0); 4.3026 (4.2); 4.2872 (4.2); 4.2689 (2.6); 4.2534 (2.4); 4.2264 (0.4); 3.3585 (0.6); 3.3239
(332.2); 2.8986 (14.0); 2.7394 (12.9); 2.5092 (37.8); 2.5054 (29.5); 1.2442 (0.8)
I-513: ¹H-NMR(400.1 MHz, d₆-DMSO):
δ = 8.9371 (1.7); 8.9168 (1.8); 7.9600 (1.2); 7.7201 (6.2); 7.4109 (3.4); 7.2784 (2.5); 7.2523 (5.4);
7.1480 (0.6); 7.1279 (2.1); 7.1170 (1.5); 7.1103 (4.2); 7.1000 (1.5); 7.0961 (1.5); 7.0801 (0.6); 6.9535
(1.9); 6.9321 (1.7); 6.9151 (0.8); 6.9073 (0.8); 6.8984 (1.4); 6.8929 (1.3); 6.8790 (0.8); 5.4316 (0.9);
5.4135 (1.3); 5.3958 (1.0); 3.7010 (16.0); 3.3383 (145.5); 2.8976 (7.0); 2.7384 (6.5); 2.5753 (15.4);
2.5130 (12.6); 2.5091 (16.6); 2.5051 (12.8); 2.2148 (13.2); 2.0630 (0.6); 2.0550 (0.8); 2.0424 (1.2);
2.0296 (0.8); 2.0217 (0.7); 2.0087 (0.4); 1.6036 (6.1); 1.5867 (6.2); 1.0317 (0.7); 1.0208 (2.2); 1.0156
(2.4); 0.9998 (2.3); 0.9946 (2.4); 0.9847 (1.0); 0.7814 (0.9); 0.7668 (2.8); 0.7584 (2.7); 0.7539 (2.8);
0.7425 (0.9)
I-514: ¹H-NMR(400.0 MHz, d₆-DMSO):
δ = 9.1590 (1.8); 9.1434 (3.7); 9.1279 (1.8); 8.0572 (16.0); 7.7653 (1.4); 7.7454 (4.3); 7.7258 (4.3);
7.7098 (5.3); 7.6903 (2.2); 7.6496 (6.0); 7.5764 (3.5); 7.5612 (7.4); 7.5404 (11.7); 7.5016 (11.9);
7.4802 (5.9); 4.1539 (1.8); 4.1384 (1.8); 4.1190 (3.9); 4.1034 (3.8); 4.0843 (2.0); 4.0683 (1.9); 3.3413
(142.0); 3.3360 (122.7); 3.3336 (136.7); 2.6725 (0.6); 2.5427 (3.4); 2.5077 (76.8); 2.5034 (103.7);
2.4992 (78.7); 2.3305 (0.6); 2.2151 (0.6); 0.0000 (2.3)
I-515: ¹H-NMR(300.2 MHz, CDCl3):
δ = 8.4850 (10.0); 8.2617 (16.0); 8.1042 (0.9); 8.0848 (1.8); 8.0658 (1.0); 7.7032 (0.4); 7.6765 (2.8);
7.6569 (7.4); 7.5461 (3.8); 7.5162 (1.6); 7.5062 (2.2); 7.4986 (1.7); 7.4859 (1.5); 7.4782 (0.9); 7.3955
(3.5); 7.3690 (4.0); 7.3041 (16.8); 7.0865 (4.0); 6.9982 (2.2); 6.9724 (1.9); 4.3470 (1.7); 4.3272 (1.6);
4.2989 (3.6); 4.2792 (3.5); 4.2509 (1.8); 4.2311 (1.7); 2.5362 (11.7); 2.3232 (16.0); 1.6962 (0.3);
1.6708 (0.3); 1.2969 (0.4); 0.0528 (0.6); 0.0421 (14.1); 0.0313 (0.4)
I-516: ¹H-NMR(499.9 MHz, CDCl3):
δ = 7.6369 (3.0); 7.5640 (0.4); 7.5480 (2.1); 7.5358 (5.3); 7.5269 (0.6); 7.4410 (3.2); 7.4348 (2.8);
7.4248 (3.2); 7.3607 (0.9); 7.3554 (1.4); 7.3502 (1.2); 7.3398 (2.7); 7.3227 (1.5); 7.2603 (4.0); 6.7089
(0.7); 6.6965 (1.4); 6.6841 (0.7); 4.3852 (1.0); 4.3724 (1.0); 4.3562 (2.2); 4.3434 (2.1); 4.3272 (1.1);
4.3144 (1.0); 2.3239 (16.0); 1.5693 (6.9); −0.0002 (3.8)
I-517: ¹H-NMR(300.2 MHz, CDCl3):
δ = 8.3344 (10.6); 7.6530 (1.7); 7.6296 (7.1); 7.6065 (2.8); 7.5803 (0.8); 7.3041 (8.2); 7.2953 (3.6);
7.2740 (3.2); 7.2681 (3.4); 7.2497 (3.4); 7.2443 (3.6); 7.2359 (1.0); 7.0850 (0.7); 7.0791 (0.7); 7.0613
(1.9); 7.0552 (2.0); 7.0446 (1.7); 7.0381 (2.9); 7.0309 (1.8); 7.0205 (2.5); 7.0152 (2.4); 6.9966 (1.1);
6.9912 (0.9); 6.9706 (2.6); 6.9475 (1.3); 6.9412 (1.0); 5.3411 (0.5); 4.1986 (1.1); 4.1748 (3.5); 4.1510
(3.6); 4.1272 (1.2); 3.9956 (0.5); 3.9808 (0.6); 3.9735 (0.5); 3.9587 (0.7); 3.9497 (1.6); 3.9349 (1.7);
3.9278 (1.7); 3.9129 (1.7); 3.9057 (1.6); 3.8894 (1.9); 3.8845 (1.8); 3.8684 (1.6); 3.8600 (0.6); 3.8436
(0.6); 3.8386 (0.7); 3.8226 (0.6); 3.2700 (1.0); 3.2511 (1.3); 3.2338 (0.9); 2.7853 (0.4); 2.7485 (1.0);
2.7282 (2.4); 2.7074 (2.1); 2.6865 (0.9); 2.0875 (16.0); 2.0604 (0.5); 2.0490 (0.9); 2.0293 (1.0);
2.0196 (1.0); 1.9999 (1.0); 1.9902 (0.8); 1.9712 (0.8); 1.9552 (0.9); 1.9379 (1.0); 1.9106 (0.8); 1.8892
(0.4); 1.8329 (0.6); 1.8035 (2.0); 1.7801 (2.1); 1.7659 (1.6); 1.7501 (1.6); 1.7294 (0.5); 1.6378 (7.4);
1.3256 (4.3); 1.3018 (8.7); 1.2780 (4.1); 0.0427 (6.1)
I-518: ¹H-NMR(400.1 MHz, CDCl3):
δ = 8.5192 (4.6); 8.5132 (4.5); 8.4184 (4.1); 8.4130 (4.0); 8.2831 (11.8); 7.7769 (0.9); 7.7632 (1.4);
7.4442 (1.7); 7.4384 (2.9); 7.4326 (1.6); 7.4227 (1.7); 7.4168 (2.9); 7.4110 (1.5); 7.3381 (3.5); 7.3182
(3.9); 7.2597 (27.8); 7.0527 (4.0); 6.9956 (0.3); 6.9820 (2.2); 6.9621 (1.9); 5.2983 (0.6); 4.3054 (0.3);
4.2575 (1.9); 4.2427 (1.9); 4.2212 (4.0); 4.2064 (3.8); 4.1848 (2.0); 4.1701 (1.9); 2.4732 (11.7);
2.3048 (16.0); 1.5462 (19.6); 1.4222 (0.4); 1.3363 (0.4); 1.2847 (0.7); 1.2554 (5.8); 0.8804 (0.6);
0.8534 (0.5); 0.8450 (0.5); 0.8349 (0.5); −0.0002 (27.6); −0.0083 (1.2)
I-519: ¹H-NMR(300.2 MHz, CDCl3):
δ = 8.3088 (12.3); 7.9976 (0.9); 7.9791 (1.6); 7.9597 (0.9); 7.7130 (0.4); 7.6833 (4.0); 7.6777 (3.2);
7.6689 (6.8); 7.6661 (7.9); 7.5463 (3.6); 7.4943 (0.5); 7.4801 (1.6); 7.4670 (2.3); 7.4596 (4.8); 7.4508
(1.9); 7.4413 (1.4); 7.4315 (5.1); 7.4059 (4.5); 7.3303 (2.8); 7.2987 (22.7); 5.3380 (3.7); 4.3104 (2.0);
4.2903 (1.9); 4.2618 (4.2); 4.2416 (4.0); 4.2130 (2.2); 4.1929 (2.0); 3.1635 (9.2); 2.5503 (6.9); 2.5436
(12.3); 2.5362 (7.0); 2.2095 (0.8); 1.5898 (16.0); 1.2921 (0.6); 0.1075 (5.5); 0.0483 (0.9); 0.0374
(21.4); 0.0266 (0.9)
I-520: ¹H-NMR(400.1 MHz, CDCl3):
δ = 8.1637 (12.7); 7.9439 (2.1); 7.8363 (1.6); 7.5641 (5.1); 7.4208 (0.9); 7.4043 (1.7); 7.3997 (2.3);
7.3878 (3.3); 7.3841 (3.5); 7.3668 (7.4); 7.3432 (4.0); 7.3391 (3.8); 7.3220 (1.5); 7.3180 (1.6); 7.1896
(19.4); 7.0342 (1.2); 7.0285 (1.3); 7.0134 (2.1); 7.0098 (2.3); 6.9927 (1.1); 6.9881 (1.1); 6.9434 (2.2);
6.9383 (2.8); 6.9194 (5.3); 6.9168 (4.7); 6.8988 (2.0); 6.8930 (2.8); 6.8874 (1.3); 4.3607 (2.1); 4.3453
(2.0); 4.3247 (4.4); 4.3093 (4.3); 4.2886 (2.2); 4.2733 (2.1); 2.8831 (16.0); 2.8104 (14.6); 1.4791 (14.4)
I-521: ¹H-NMR(400.1 MHz, CDCl3):
δ = 8.2349 (16.0); 8.0138 (1.9); 7.9091 (2.2); 7.5303 (6.2); 7.5090 (7.3); 7.4769 (7.4); 7.4679 (3.9);
7.4516 (4.0); 7.4310 (2.1); 7.2594 (36.1); 7.2409 (3.5); 7.2365 (3.3); 7.1041 (1.7); 7.0984 (1.9);
7.0833 (3.2); 7.0780 (3.4); 7.0626 (1.6); 7.0573 (1.6); 7.0157 (3.1); 7.0110 (4.0); 6.9905 (7.2); 6.9853
(4.0); 6.9682 (2.6); 6.9626 (3.8); 6.9571 (1.8); 4.4336 (2.9); 4.4184 (2.9); 4.3977 (6.2); 4.3823 (6.0);
4.3616 (3.2); 4.3462 (3.0); 2.9535 (13.6); 2.8807 (12.8); 1.5463 (24.8); −0.0002 (2.6)
I-522: ¹H-NMR(300.2 MHz, CDCl3):
δ = 7.6616 (1.2); 7.6354 (7.7); 7.6321 (7.7); 7.6298 (7.8); 7.5973 (1.3); 7.5710 (5.7); 7.5502 (16.0);
7.5332 (1.5); 7.5292 (1.5); 7.5158 (1.8); 7.5114 (2.9); 7.4989 (0.7); 7.4876 (0.5); 7.4713 (0.4); 7.4344
(12.7); 7.4063 (10.5); 7.3765 (0.7); 7.3703 (0.6); 7.3592 (2.8); 7.3500 (5.0); 7.3429 (3.5); 7.3364
(2.0); 7.3281 (3.2); 7.3212 (2.0); 7.2987 (16.9); 7.2926 (6.2); 7.2864 (5.6); 7.2644 (3.8); 7.2583 (3.7);
7.0238 (1.7); 7.0035 (3.1); 6.9837 (1.7); 6.7111 (1.5); 5.3353 (1.3); 4.4043 (3.4); 4.3835 (3.3); 4.3557
(7.2); 4.3349 (6.9); 4.3070 (3.7); 4.2863 (3.5); 3.4540 (0.6); 3.4041 (1.1); 3.3540 (0.6); 2.9945 (0.6);
2.9828 (1.3); 2.9726 (2.1); 2.9603 (2.9); 2.9515 (3.0); 2.9390 (2.2); 2.9289 (1.4); 2.9167 (0.6); 2.2028
(5.6); 2.0100 (1.2); 1.6087 (4.9); 1.2919 (2.0); 0.9164 (0.5); 0.8981 (1.9); 0.8741 (7.5); 0.8568 (7.6);
0.8512 (6.3); 0.8334 (2.5); 0.8040 (0.4); 0.7810 (0.4); 0.7586 (0.4); 0.7461 (0.4); 0.7051 (2.7); 0.6890
(6.8); 0.6814 (8.0); 0.6767 (6.8); 0.6528 (1.7); 0.1077 (3.3); 0.0470 (0.5); 0.0362 (14.4); 0.0252 (0.6)
I-523: ¹H-NMR(300.2 MHz, CDCl3):
δ = 8.8840 (5.4); 7.9265 (0.4); 7.9069 (0.8); 7.8867 (0.4); 7.6685 (3.1); 7.6588 (3.8); 7.5434 (1.7);
7.5092 (1.3); 7.4808 (3.6); 7.4682 (0.9); 7.4495 (2.1); 7.4444 (1.8); 7.4214 (0.7); 7.4156 (0.6); 7.2984
(2.2); 4.5078 (0.9); 4.4872 (0.9); 4.4596 (1.9); 4.4391 (1.8); 4.4114 (0.9); 4.3909 (0.9); 4.0954 (16.0);
2.3932 (14.8); 2.0370 (1.2); 1.6173 (0.9); 0.0353 (1.7)
I-524: ¹H-NMR(400.1 MHz, d₆-DMSO):
δ = 8.8307 (0.7); 8.8166 (1.4); 8.8025 (0.8); 7.7599 (0.5); 7.7402 (1.7); 7.7206 (1.6); 7.7011 (2.0);
7.6813 (1.0); 7.6533 (2.3); 7.5903 (1.3); 7.5701 (1.1); 7.0381 (2.1); 7.0175 (2.3); 6.5132 (2.5); 6.5075
(2.6); 6.2638 (1.4); 6.2579 (1.4); 6.2432 (1.4); 6.2373 (1.3); 3.7666 (14.2); 3.7260 (0.4); 3.6790
(16.0); 3.5833 (1.7); 3.5657 (3.7); 3.5482 (2.0); 3.5203 (0.9); 3.5038 (2.1); 3.4885 (2.2); 3.4719 (1.0);
3.3156 (15.7); 3.2539 (17.1); 3.2309 (0.4); 3.2157 (0.4); 2.9598 (1.5); 2.9424 (2.9); 2.9248 (1.5);
2.8998 (1.8); 2.7494 (1.5); 2.7409 (2.2); 2.7323 (3.1); 2.7150 (1.5); 2.5143 (7.8); 2.5100 (10.4);
2.5057 (8.0)
I-525: ¹H-NMR(400.1 MHz, CDCl3):
δ = 8.7854 (0.6); 8.1731 (1.9); 8.1327 (5.4); 7.7060 (1.0); 7.6863 (1.1); 7.5883 (3.4); 7.5754 (3.3);
7.4322 (2.0); 7.3687 (0.7); 7.3625 (0.8); 7.3558 (1.1); 7.3510 (1.0); 7.3462 (0.7); 7.3400 (0.5); 7.2775
(1.8); 7.2600 (11.8); 6.6482 (1.1); 6.5086 (2.3); 6.3691 (1.1); 4.0124 (1.1); 3.9980 (2.4); 3.9828 (2.4);
3.9683 (1.1); 3.1975 (1.5); 3.1827 (2.2); 3.1679 (1.4); 2.7146 (16.0); 1.5679 (2.1); 0.0078 (0.6); −0.0002
(13.5); −0.0083 (0.5)
I-526: ¹H-NMR(400.1 MHz, d₆-DMSO):
δ = 9.3373 (1.5); 9.3213 (3.6); 9.3055 (2.0); 8.8533 (11.6); 8.7172 (6.2); 8.7048 (6.7); 8.1542 (13.8);
8.0532 (1.5); 7.9605 (2.6); 7.7660 (5.4); 7.7617 (5.9); 7.7203 (5.9); 7.7080 (6.0); 7.6191 (4.9); 7.5978
(5.8); 7.5838 (1.0); 7.5206 (0.8); 7.4996 (1.8); 7.4783 (2.1); 7.4590 (1.3); 7.4088 (0.9); 7.3924 (1.9);
7.3877 (1.9); 7.3730 (2.2); 7.3561 (1.2); 7.3326 (3.3); 7.3278 (3.5); 7.3121 (4.5); 7.3063 (4.2); 7.3004
(3.3); 7.2797 (1.6); 7.2403 (0.3); 7.2208 (0.4); 4.3417 (1.5); 4.3260 (1.6); 4.3076 (3.4); 4.2919 (3.4);
4.2735 (2.1); 4.2579 (1.9); 4.2277 (0.3); 3.3234 (260.8); 2.8988 (16.0); 2.7396 (14.6); 2.5136 (19.7);
2.5094 (27.2); 2.5052 (21.2)
I-527: ¹H-NMR(400.1 MHz, CDCl3):
δ = 8.3357 (2.7); 8.2516 (6.1); 8.2487 (5.0); 7.6672 (0.3); 7.6451 (3.6); 7.6329 (6.2); 7.5445 (4.0);
7.4869 (2.0); 7.4841 (2.0); 7.4741 (1.5); 7.4249 (4.4); 7.4051 (5.5); 7.2588 (9.1); 7.2561 (7.6); 7.2359
(5.3); 7.2166 (4.6); 5.1046 (3.7); 5.0875 (7.5); 5.0561 (7.5); 5.0390 (4.0); 2.3584 (16.0); 2.0882 (1.0);
2.0001 (1.4); 1.6984 (0.6); 1.2562 (0.6); −0.0002 (9.5); −0.0029 (8.0)
I-528: ¹H-NMR(400.1 MHz, d₆-DMSO):
δ = 9.0029 (1.8); 8.9823 (1.9); 7.9600 (2.2); 7.7118 (6.3); 7.6694 (2.8); 7.6482 (3.1); 7.5275 (3.5);
7.5236 (3.5); 7.3560 (5.0); 7.1586 (0.6); 7.1382 (2.2); 7.1281 (1.5); 7.1209 (4.3); 7.1114 (1.6); 7.1073
(1.6); 7.0914 (0.6); 6.9135 (2.6); 6.9094 (2.5); 6.9044 (1.8); 6.8927 (2.3); 6.8880 (2.4); 5.4569 (0.9);
5.4387 (1.3); 5.4206 (1.0); 3.7302 (16.0); 3.3390 (98.6); 2.8974 (12.7); 2.7384 (11.7); 2.5750 (15.5);
2.5092 (11.4); 2.5053 (8.8); 2.0697 (0.6); 2.0615 (0.7); 2.0490 (1.3); 2.0363 (0.8); 2.0278 (0.7);
2.0150 (0.4); 1.5980 (6.1); 1.5809 (6.2); 1.0360 (0.7); 1.0251 (2.3); 1.0201 (2.5); 1.0041 (2.4); 0.9991
(2.5); 0.9892 (1.0); 0.7912 (0.9); 0.7772 (2.8); 0.7684 (2.8); 0.7641 (2.8); 0.7528 (0.9)
I-529: ¹H-NMR(300.2 MHz, CDCl3):
δ = 8.3209 (16.0); 7.9794 (1.7); 7.6817 (6.8); 7.6644 (9.2); 7.6506 (0.6); 7.5199 (4.7); 7.4999 (3.8);
7.4862 (2.1); 7.4779 (5.4); 7.4737 (5.8); 7.4654 (2.0); 7.4570 (1.2); 7.3827 (1.1); 7.3581 (3.0); 7.3336
(2.6); 7.3047 (13.7); 7.2885 (4.0); 7.2634 (2.1); 7.2239 (2.0); 7.1988 (2.9); 7.1736 (1.2); 5.3430 (0.4);
4.3324 (2.7); 4.3125 (2.6); 4.2839 (5.6); 4.2640 (5.4); 4.2354 (2.8); 4.2155 (2.7); 4.1762 (0.4); 4.1523
(0.4); 2.5729 (8.3); 2.5656 (15.3); 2.5580 (8.4); 2.2147 (0.5); 2.0888 (1.8); 1.6077 (12.6); 1.3268
(0.6); 1.3029 (1.4); 1.2791 (0.5); 0.0546 (0.5); 0.0438 (13.0); 0.0329 (0.4)
I-530: ¹H-NMR(400.1 MHz, CDCl3):
δ = 8.2281 (12.8); 8.0140 (2.2); 7.7901 (1.8); 7.6333 (5.7); 7.5188 (0.3); 7.4713 (3.3); 7.4501 (7.4);
7.4201 (4.3); 7.4164 (4.1); 7.3988 (1.9); 7.3952 (1.8); 7.2593 (20.9); 7.2297 (3.5); 7.2197 (2.8);
7.2124 (5.8); 7.1979 (4.5); 7.1902 (1.9); 7.1751 (0.5); 7.1501 (1.2); 7.1460 (1.3); 7.1369 (2.4); 7.1299
(2.2); 7.1221 (1.5); 7.1149 (1.2); 4.4466 (2.2); 4.4311 (2.2); 4.4111 (4.8); 4.3956 (4.7); 4.3756 (2.5);
4.3601 (2.4); 2.9532 (16.0); 2.8804 (15.0); 1.5465 (20.9)
I-531: ¹H-NMR(400.1 MHz, CDCl3):
δ = 8.2279 (14.6); 8.0134 (2.1); 7.7951 (1.8); 7.5435 (5.1); 7.5223 (6.0); 7.5015 (0.3); 7.4758 (5.6);
7.2677 (3.7); 7.2598 (29.0); 7.2469 (3.1); 7.2420 (3.1); 7.2286 (3.6); 7.2191 (2.8); 7.2109 (6.5);
7.1966 (4.6); 7.1893 (2.2); 7.1744 (0.5); 7.1618 (0.4); 7.1526 (1.3); 7.1484 (1.4); 7.1397 (2.5); 7.1322
(2.3); 7.1239 (1.6); 7.1170 (1.2); 7.1123 (0.9); 7.1080 (0.8); 4.4495 (2.4); 4.4341 (2.4); 4.4141 (5.2);
4.3986 (5.1); 4.3785 (2.7); 4.3630 (2.6); 2.9536 (16.0); 2.8803 (14.6); 1.5510 (17.0); 1.2556
(0.5); −0.0002 (2.2)
I-532: ¹H-NMR(400.1 MHz, d₆-DMSO):
δ = 9.2978 (1.1); 9.2826 (2.4); 9.2669 (1.4); 8.8551 (8.2); 8.7192 (4.2); 8.7069 (4.5); 8.1910 (8.9);
8.0839 (0.9); 7.9606 (2.8); 7.7262 (4.0); 7.7139 (4.1); 7.6132 (4.1); 7.5922 (7.3); 7.5363 (7.0); 7.5153
(4.8); 7.5012 (2.1); 7.4776 (1.7); 7.4562 (1.0); 7.4080 (0.7); 7.3909 (1.4); 7.3868 (1.4); 7.3721 (1.6);
7.3539 (1.0); 7.3197 (1.6); 7.3029 (1.9); 7.2827 (1.0); 4.1906 (1.1); 4.1753 (1.2); 4.1562 (2.4); 4.1408
(2.5); 4.1219 (1.5); 4.1061 (1.4); 3.3258 (158.2); 2.8987 (16.0); 2.7395 (15.0); 2.5095 (20.3); 1.2448 (0.4)
I-533: ¹H-NMR(300.2 MHz, CDCl3):
δ = 7.4619 (1.7); 7.4341 (4.0); 7.3769 (1.1); 7.3497 (2.3); 7.3222 (1.4); 7.2992 (11.9); 7.2433 (1.4);
7.2363 (1.2); 7.2154 (1.0); 7.2086 (1.0); 6.8639 (0.9); 6.8560 (1.1); 6.8359 (0.8); 6.8281 (0.9); 6.8074
(0.9); 6.8022 (1.1); 6.7804 (0.7); 6.7756 (1.2); 6.7616 (1.7); 6.7540 (2.2); 6.7465 (1.0); 6.5795 (0.4);
6.5592 (0.7); 6.5388 (0.4); 6.0854 (0.4); 6.0753 (0.4); 6.0627 (0.4); 6.0524 (0.4); 5.9306 (0.4); 5.9202
(0.4); 5.9080 (0.4); 5.8975 (0.4); 5.3379 (1.5); 4.1928 (0.5); 4.1692 (0.8); 4.1449 (0.8); 4.1216 (0.4);
4.1162 (0.4); 4.1052 (0.3); 4.1002 (0.4); 4.0943 (0.4); 3.9415 (0.4); 3.9215 (0.3); 3.8889 (0.4); 3.8687
(0.5); 3.8328 (16.0); 2.4229 (14.3); 2.0819 (3.6); 1.5991 (11.5); 1.3204 (0.8); 1.2965 (1.7); 1.2727
(0.7); 0.9728 (0.5); 0.1073 (4.4); 0.0486 (0.5); 0.0377 (11.6); 0.0271 (0.4)
I-534: ¹H-NMR(400.1 MHz, CDCl3):
δ = 7.5594 (0.3); 7.5383 (2.4); 7.5331 (2.0); 7.5264 (4.0); 7.5245 (4.3); 7.4822 (2.8); 7.4608 (4.0);
7.4145 (2.2); 7.3767 (4.0); 7.3553 (2.9); 7.3441 (1.0); 7.3410 (1.2); 7.3360 (1.2); 7.3282 (0.9); 7.3218
(0.6); 7.2602 (5.7); 6.6676 (0.6); 6.6522 (1.1); 6.6372 (0.6); 5.2974 (1.0); 4.1829 (1.0); 4.1671 (1.0);
4.1471 (2.1); 4.1313 (2.0); 4.1112 (1.0); 4.0954 (1.0); 2.3091 (16.0); 1.5652 (4.4); −0.0002 (5.2)
I-535: ¹H-NMR(400.1 MHz, CDCl3):
δ = 8.2387 (16.0); 8.0127 (1.9); 7.7783 (1.3); 7.7653 (2.2); 7.5406 (5.7); 7.5193 (7.0); 7.4935 (6.2);
7.4909 (6.4); 7.2972 (4.0); 7.2922 (4.3); 7.2847 (4.1); 7.2765 (4.3); 7.2705 (5.1); 7.2595 (36.2);
7.2064 (5.9); 7.2043 (5.8); 6.9668 (2.3); 6.9614 (4.0); 6.9560 (2.1); 6.9451 (2.4); 6.9396 (4.0); 6.9342
(2.0); 4.4285 (2.7); 4.4132 (2.7); 4.3922 (5.7); 4.3769 (5.5); 4.3559 (2.9); 4.3405 (2.8); 2.9536 (13.4);
2.8803 (12.5); 1.5456 (25.2); −0.0002 (2.7)
I-536: ¹H-NMR(400.1 MHz, d₆-DMSO):
δ = 8.9333 (1.6); 8.9188 (3.4); 8.9040 (1.8); 7.9612 (2.4); 7.7050 (13.8); 7.6504 (5.9); 7.5609 (5.4);
7.5398 (7.0); 7.3942 (3.9); 7.3891 (3.9); 7.3732 (3.2); 7.3681 (3.2); 7.3342 (3.0); 7.3145 (6.4); 7.2948
(3.8); 6.9909 (3.8); 6.9714 (3.5); 6.9514 (2.9); 6.9472 (3.5); 6.9313 (2.4); 6.9272 (3.4); 6.9018 (4.8);
6.8974 (6.3); 6.0526 (1.1); 6.0399 (2.3); 6.0272 (1.2); 5.9370 (1.1); 5.9245 (2.2); 5.9116 (1.2); 3.8783
(2.0); 3.8645 (3.7); 3.8505 (2.3); 3.8208 (1.8); 3.8075 (3.5); 3.7932 (2.2); 3.3144 (181.7); 2.8993
(16.0); 2.7405 (14.3); 2.5927 (34.7); 2.5494 (0.5); 2.5138 (18.3); 2.5094 (25.2); 2.5050 (19.0); 2.4310
(0.4); 1.9950 (0.7); 1.9820 (1.4); 1.9736 (1.6); 1.9613 (3.0); 1.9489 (1.8); 1.9404 (1.7); 1.9278 (0.9);
1.0008 (1.7); 0.9899 (5.0); 0.9845 (5.5); 0.9741 (2.8); 0.9689 (5.4); 0.9636 (5.4); 0.9533 (2.2); 0.9366
(0.4); 0.7059 (2.0); 0.6952 (5.8); 0.6904 (6.0); 0.6830 (5.7); 0.6780 (6.4); 0.6667 (2.0)
I-537: ¹H-NMR(400.1 MHz, d₆-DMSO):
δ = 9.2145 (1.1); 9.1996 (2.2); 9.1838 (1.2); 8.6068 (4.3); 8.5742 (2.4); 8.5622 (2.5); 8.0196 (6.4);
7.9606 (3.4); 7.8708 (4.3); 7.7953 (0.8); 7.7756 (2.3); 7.7559 (2.1); 7.7308 (3.0); 7.7116 (1.6); 7.6915
(3.7); 7.6232 (2.2); 7.6039 (1.8); 7.5252 (2.3); 7.5038 (3.5); 7.4940 (3.1); 7.4815 (2.9); 7.4101 (2.6);
7.3889 (1.9); 4.3331 (0.9); 4.3173 (1.1); 4.2990 (2.1); 4.2833 (2.1); 4.2647 (1.2); 4.2493 (1.1); 3.3221
(116.4); 2.8978 (16.0); 2.7386 (15.2); 2.5118 (16.7); 2.5082 (17.9); 2.3393 (15.2); 1.2448 (0.3)
I-538: ¹H-NMR(400.0 MHz, CD3CN):
δ = 8.0071 (16.0); 7.8600 (1.1); 7.7436 (5.4); 7.7393 (5.4); 7.7306 (3.8); 7.7109 (4.6); 7.7031 (4.9);
7.6834 (1.4); 7.5939 (4.7); 7.5449 (2.6); 7.5239 (8.6); 7.5014 (6.6); 7.4967 (5.6); 7.4803 (1.6); 7.4754
(1.6); 4.2095 (2.8); 4.1931 (2.8); 4.1761 (5.9); 4.1597 (5.8); 4.1427 (3.0); 4.1264 (2.9); 2.2793 (86.3);
2.2771 (89.0); 2.2691 (109.4); 2.2580 (201.4); 2.1372 (0.4); 1.9943 (4.5); 1.9881 (3.9); 1.9823 (22.0);
1.9762 (40.2); 1.9700 (54.1); 1.9638 (37.0); 1.9576 (19.0); 1.7984 (0.3)
I-539: ¹H-NMR(300.2 MHz, CDCl3):
δ = 10.2628 (1.6); 10.2431 (1.6); 8.4329 (14.0); 8.2334 (4.5); 8.2052 (4.8); 7.8589 (2.5); 7.8549 (2.2);
7.8503 (1.8); 7.8343 (3.4); 7.8276 (3.1); 7.7971 (4.1); 7.7346 (6.5); 7.7314 (5.9); 7.7224 (4.0); 7.7147
(5.9); 7.6882 (0.9); 7.6754 (0.6); 7.6640 (2.2); 7.6559 (2.3); 7.6445 (2.2); 7.6385 (1.7); 7.6327 (1.1);
7.6250 (0.9); 7.6130 (0.8); 7.6073 (1.0); 7.5900 (2.6); 7.5841 (2.3); 7.5655 (4.8); 7.5612 (4.8); 7.5579
(3.8); 7.5430 (2.4); 7.5376 (3.0); 7.5199 (1.2); 7.5146 (0.8); 7.4490 (3.2); 7.4435 (3.2); 7.4330 (6.6);
7.4190 (2.4); 7.4048 (6.0); 7.3051 (10.1); 5.5500 (0.6); 5.5280 (2.3); 5.5065 (3.4); 5.4850 (2.4);
5.4629 (0.6); 4.1773 (0.4); 4.1535 (0.4); 2.0899 (1.9); 1.7617 (16.0); 1.7394 (15.9); 1.6418 (1.7);
1.3271 (0.6); 1.3032 (1.3); 1.2794 (0.6); 0.0544 (0.4); 0.0436 (9.8); 0.0327 (0.4)
I-540: ¹H-NMR(400.1 MHz, CDCl3):
δ = 8.2330 (12.8); 8.0134 (2.1); 7.8699 (0.9); 7.8558 (1.6); 7.8423 (0.9); 7.5447 (4.4); 7.5234 (5.2);
7.4856 (4.8); 7.4609 (2.9); 7.4537 (3.2); 7.4470 (3.0); 7.4399 (3.0); 7.2938 (2.8); 7.2890 (2.8); 7.2724
(2.7); 7.2669 (4.9); 7.2597 (29.4); 7.2445 (4.1); 7.2249 (3.5); 7.1739 (2.0); 7.1644 (2.6); 7.1570 (2.0);
7.1515 (1.4); 7.1421 (1.6); 7.1346 (1.1); 4.4307 (2.1); 4.4154 (2.0); 4.3944 (4.3); 4.3791 (4.2); 4.3579
(2.2); 4.3427 (2.1); 2.9536 (16.0); 2.8804 (14.6); 1.5491 (15.0); −0.0002 (2.4)
I-541: ¹H-NMR(400.0 MHz, d₆-DMSO):
δ = 8.7379 (1.0); 8.7241 (1.9); 8.7100 (1.0); 8.0791 (9.8); 7.9535 (0.4); 7.7539 (0.7); 7.7335 (2.4);
7.7136 (2.5); 7.6968 (3.1); 7.6838 (4.1); 7.5939 (2.0); 7.5740 (1.5); 6.8315 (5.4); 6.6811 (12.0);
6.6622 (0.3); 5.8895 (16.0); 3.5257 (1.2); 3.5089 (3.3); 3.4935 (3.4); 3.4769 (1.4); 3.3483 (22.6);
3.3430 (30.4); 3.3400 (28.2); 2.8919 (2.3); 2.7722 (2.5); 2.7549 (5.1); 2.7337 (3.1); 2.5131 (7.8);
2.5090 (15.9); 2.5046 (21.1); 2.5001 (15.4); 1.2390 (0.6); −0.0002 (1.6)
I-542: ¹H-NMR(300.1 MHz, MeOD):
δ = 8.8316 (2.4); 8.8155 (2.6); 8.2526 (4.2); 8.2314 (3.9); 8.0036 (16.0); 7.8268 (6.8); 7.7990 (8.6);
7.6508 (1.1); 7.6249 (3.2); 7.5986 (3.0); 7.5620 (11.1); 7.5342 (8.8); 7.5216 (4.8); 7.4852 (2.6);
7.4573 (1.8); 5.4981 (0.4); 4.9604 (17.5); 3.8268 (3.2); 3.8040 (7.2); 3.7813 (3.6); 3.3394 (1.8);
3.3340 (3.4); 3.3286 (4.7); 3.3232 (3.3); 3.3179 (1.7); 3.1089 (3.4); 3.0863 (6.8); 3.0635 (3.0); 3.0052
(0.8); 2.8719 (0.7)
I-543: ¹H-NMR(400.1 MHz, CDCl3):
δ = 8.0945 (4.9); 8.0166 (0.6); 7.8239 (0.6); 7.5498 (3.3); 7.5324 (1.5); 7.5127 (0.5); 7.2719 (1.3);
7.2686 (1.4); 7.2605 (10.7); 7.2529 (1.7); 7.2496 (1.6); 7.2142 (2.1); 7.2099 (1.9); 7.1903 (0.8);
7.1852 (1.1); 7.1796 (0.5); 7.1152 (0.8); 7.0997 (2.2); 7.0875 (2.3); 7.0684 (2.2); 7.0495 (0.7); 4.0086
(0.9); 3.9927 (2.3); 3.9771 (2.2); 3.9617 (1.0); 3.3158 (1.8); 3.2993 (3.0); 3.2830 (1.6); 2.9543 (4.9);
2.8822 (4.5); 2.7751 (0.6); 2.7216 (0.4); 2.6975 (14.4); 2.5238 (0.6); 2.4628 (16.0); 1.5895 (3.6);
0.0078 (0.5); −0.0002 (13.2); −0.0083 (0.5)
I-544: ¹H-NMR(400.1 MHz, d₆-DMSO):
δ = 8.9888 (1.3); 8.9744 (2.6); 8.9595 (1.4); 7.9612 (2.5); 7.7481 (10.7); 7.6499 (4.6); 7.5765 (4.2);
7.5555 (5.4); 7.4143 (3.0); 7.4093 (3.0); 7.3934 (2.5); 7.3883 (2.5); 7.1881 (0.9); 7.1676 (3.7); 7.1586
(2.4); 7.1506 (7.2); 7.1419 (2.4); 7.1373 (2.6); 7.1219 (1.0); 7.1172 (0.7); 6.9425 (1.2); 6.9344 (1.2);
6.9262 (2.2); 6.9200 (2.1); 6.9072 (1.4); 6.9024 (1.2); 6.0788 (0.9); 6.0675 (1.2); 6.0527 (1.0); 5.9628
(0.8); 5.9518 (1.2); 5.9483 (1.2); 5.9373 (1.0); 3.9345 (0.4); 3.9142 (0.8); 3.8984 (1.5); 3.8757 (1.3);
3.8609 (1.4); 3.8436 (1.5); 3.8278 (1.6); 3.8144 (1.2); 3.8033 (0.8); 3.7920 (0.4); 3.7784 (0.4); 3.3145
(140.5); 2.8992 (16.0); 2.7403 (14.4); 2.5966 (26.6); 2.5474 (0.4); 2.5137 (14.7); 2.5094 (20.0);
2.5050 (15.0); 2.1023 (0.4); 2.0889 (1.0); 2.0808 (1.2); 2.0683 (2.0); 2.0557 (1.3); 2.0472 (1.2);
2.0345 (0.6); 1.0459 (1.2); 1.0349 (3.6); 1.0295 (4.0); 1.0192 (2.2); 1.0138 (3.9); 1.0085 (4.0); 0.9984
(1.7); 0.9821 (0.4); 0.8021 (1.5); 0.7916 (4.2); 0.7871 (4.5); 0.7790 (4.3); 0.7742 (4.6); 0.7628 (1.5)
I-545: ¹H-NMR(400.1 MHz, d₆-DMSO):
δ = 9.0983 (1.0); 9.0841 (2.1); 9.0699 (1.2); 8.6138 (4.1); 8.5809 (2.4); 8.5691 (2.5); 8.1246 (0.4);
8.1051 (5.9); 7.9610 (3.5); 7.7933 (0.8); 7.7738 (2.5); 7.7530 (6.7); 7.7371 (4.6); 7.7096 (2.0); 7.6618
(2.3); 7.6429 (1.9); 7.5178 (3.0); 7.5024 (10.2); 6.0829 (0.6); 6.0701 (1.3); 6.0583 (0.7); 5.9672 (0.6);
5.9551 (1.3); 5.9434 (0.8); 3.9390 (1.1); 3.9263 (2.1); 3.9131 (1.4); 3.8828 (1.2); 3.8689 (2.1); 3.8568
(1.3); 3.3266 (98.6); 2.9832 (0.4); 2.9002 (15.7); 2.7408 (15.1); 2.5113 (19.6); 2.5075 (19.3); 2.3573 (16.0)
I-546: ¹H-NMR(300.2 MHz, CDCl3):
δ = 7.6266 (3.6); 7.6246 (3.6); 7.6030 (1.4); 7.5893 (4.5); 7.5871 (4.7); 7.5818 (3.5); 7.4760 (1.5);
7.4503 (0.7); 7.4387 (0.9); 7.4319 (0.7); 7.4206 (0.6); 7.4123 (0.4); 7.3448 (1.4); 7.3182 (1.6); 7.2986
(8.1); 7.0478 (1.6); 6.9390 (0.9); 6.9127 (0.8); 6.6787 (0.4); 6.6591 (0.8); 6.6386 (0.4); 4.1682 (0.7);
4.1476 (0.7); 4.1196 (1.6); 4.0989 (1.5); 4.0710 (0.8); 4.0504 (0.8); 3.8587 (16.0); 2.4739 (4.8);
2.4669 (2.7); 2.2904 (6.3); 1.6088 (3.2); 1.2941 (0.4); 0.1090 (0.5); 0.0387 (8.0)
I-547: ¹H-NMR(400.1 MHz, d₆-DMSO):
δ = 9.1125 (2.3); 9.0923 (2.3); 7.7190 (0.8); 7.6994 (2.3); 7.6762 (4.5); 7.6537 (1.5); 7.6149 (2.5);
7.6082 (2.9); 7.5938 (2.8); 7.5871 (3.1); 7.5124 (8.1); 7.4984 (6.8); 7.3666 (4.7); 7.3604 (5.4); 6.8030
(2.6); 6.7822 (2.6); 5.4488 (1.3); 5.4320 (1.9); 5.4176 (1.4); 3.7162 (14.1); 3.7096 (16.0); 3.3438
(77.7); 3.3366 (88.4); 2.9026 (0.4); 2.8954 (0.5); 2.7358 (0.4); 2.5101 (18.4); 2.3412 (13.8); 2.3346
(15.6); 1.5990 (7.6); 1.5885 (7.1); 1.5825 (7.4)
I-548: ¹H-NMR(300.2 MHz, CDCl3):
δ = 8.3140 (16.0); 7.9589 (1.3); 7.9389 (2.0); 7.7928 (3.1); 7.7894 (3.1); 7.7661 (3.4); 7.7187 (0.4);
7.6904 (6.6); 7.6727 (9.4); 7.6490 (0.9); 7.6335 (3.6); 7.6286 (3.2); 7.6070 (4.3); 7.6022 (3.9); 7.5911
(1.2); 7.5194 (4.9); 7.5039 (0.8); 7.4898 (2.0); 7.4750 (3.0); 7.4682 (2.3); 7.4589 (1.8); 7.4506 (1.2);
7.3036 (115.6); 7.2108 (3.0); 7.1845 (5.3); 7.1579 (2.4); 6.9527 (0.6); 5.3437 (5.9); 4.5370 (2.6);
4.5168 (2.6); 4.4885 (5.6); 4.4680 (5.4); 4.4400 (3.0); 4.4195 (2.8); 2.0891 (0.9); 1.5878 (86.1);
1.4703 (0.6); 1.2974 (3.8); 0.9247 (1.2); 0.9017 (0.6); 0.8781 (0.4); 0.2378 (0.6); 0.1240 (1.8); 0.1118
(53.6); 0.0996 (2.0); 0.0880 (0.5); 0.0531 (4.0); 0.0425 (119.0); 0.0315 (4.1); −0.0869 (0.4); −0.1558 (0.5)
I-549: ¹H-NMR(400.1 MHz, CDCl3):
δ = 7.5204 (2.5); 7.5164 (2.0); 7.5074 (4.4); 7.4192 (2.2); 7.3846 (0.3); 7.3740 (0.9); 7.3644 (1.3);
7.3596 (1.3); 7.3508 (1.2); 7.3391 (2.8); 7.3126 (2.1); 7.3067 (1.8); 7.2871 (2.0); 7.2684 (1.2); 7.2595
(5.3); 7.2366 (0.7); 6.6356 (0.6); 6.6208 (1.1); 6.6059 (0.6); 5.2960 (0.6); 4.1838 (1.0); 4.1681 (1.0);
4.1476 (2.1); 4.1319 (2.0); 4.1113 (1.0); 4.0957 (1.0); 2.3803 (0.4); 2.3531 (12.2); 2.3088 (16.0);
1.5735 (5.8); 1.2559 (0.4); −0.0002 (3.4)
I-550: ¹H-NMR(300.2 MHz, CDCl3):
δ = 8.7872 (1.5); 8.7818 (1.6); 8.7708 (1.6); 8.7655 (1.6); 8.6824 (1.9); 8.6763 (1.9); 7.8437 (0.8);
7.8372 (1.1); 7.8305 (0.8); 7.8173 (0.9); 7.8109 (1.3); 7.8043 (0.9); 7.6230 (1.4); 7.6015 (4.5); 7.5807
(0.4); 7.5355 (2.1); 7.5024 (2.2); 7.4871 (1.7); 7.4791 (1.9); 7.4625 (1.0); 7.2988 (25.7); 7.2182 (1.8);
7.1916 (2.1); 7.0309 (2.2); 7.0009 (1.1); 6.9924 (1.2); 6.9548 (1.2); 6.9267 (1.0); 6.4327 (0.5); 6.4136
(1.0); 6.3950 (0.5); 4.0342 (0.7); 4.0136 (0.7); 3.9850 (1.4); 3.9644 (1.4); 3.9361 (0.7); 3.9153 (0.7);
3.6590 (5.9); 2.3950 (6.3); 2.3658 (0.4); 2.3006 (8.4); 2.2079 (0.4); 1.6092 (16.0); 1.2922 (0.4);
0.0482 (0.9); 0.0374 (25.0); 0.0265 (0.9)
I-551: ¹H-NMR(400.0 MHz, d₆-DMSO):
δ = 8.7488 (1.5); 8.7351 (3.0); 8.7210 (1.5); 8.0763 (16.0); 7.7599 (1.1); 7.7409 (3.3); 7.7202 (3.6);
7.7035 (10.8); 7.6855 (1.9); 7.6058 (3.4); 7.5864 (2.3); 7.0880 (5.7); 6.9467 (2.8); 6.9435 (2.8);
6.9266 (3.1); 6.9233 (3.0); 6.5555 (6.2); 6.5353 (5.6); 4.4352 (5.2); 4.4134 (10.9); 4.3917 (5.6);
3.5118 (1.9); 3.4947 (5.0); 3.4795 (5.1); 3.4626 (2.1); 3.3411 (85.0); 3.0177 (3.7); 2.9960 (7.2);
2.9743 (3.5); 2.8911 (0.6); 2.7685 (3.7); 2.7510 (7.5); 2.7332 (3.9); 2.5258 (0.6); 2.5123 (14.6);
2.5081 (30.3); 2.5036 (40.4); 2.4991 (29.2); 2.4948 (14.3); 1.2389 (1.2); −0.0002 (4.6)
I-552: ¹H-NMR(300.2 MHz, CDCl3):
δ = 8.5103 (11.0); 8.4735 (0.4); 7.9923 (2.8); 7.7100 (1.3); 7.6837 (6.6); 7.6644 (16.0); 7.6613 (14.4);
7.5899 (9.7); 7.5562 (7.5); 7.5067 (1.1); 7.5000 (1.1); 7.4907 (3.3); 7.4804 (4.9); 7.4732 (4.4); 7.4602
(3.7); 7.4526 (2.4); 7.4313 (1.9); 7.4263 (1.6); 7.4033 (12.7); 7.3972 (18.7); 7.3674 (1.8); 7.2994
(11.8); 6.1390 (2.1); 6.1285 (2.4); 6.1149 (2.4); 6.1044 (2.2); 6.0681 (1.1); 6.0464 (3.3); 6.0247 (3.3);
6.0030 (1.2); 5.9834 (2.2); 5.9728 (2.4); 5.9594 (2.4); 5.9487 (2.2); 5.9101 (1.1); 5.8884 (3.3); 5.8666
(3.3); 5.8449 (1.1); 4.3933 (0.6); 4.3825 (0.8); 4.3771 (0.8); 4.3702 (0.9); 4.3663 (0.9); 4.3597 (0.9);
4.3547 (0.8); 4.3443 (1.3); 4.3338 (1.0); 4.3283 (1.0); 4.3216 (1.1); 4.3177 (1.1); 4.3110 (1.1); 4.3059
(1.0); 4.3016 (1.0); 4.2949 (1.0); 4.2909 (1.0); 4.2860 (0.9); 4.2785 (1.0); 4.2678 (0.9); 4.2635 (0.8);
4.2526 (1.3); 4.2417 (1.0); 4.2371 (1.0); 4.2298 (1.1); 4.2191 (1.0); 4.2150 (0.9); 4.2040 (0.7); 3.9151
(0.7); 3.8977 (1.0); 3.8918 (1.4); 3.8748 (1.5); 3.8676 (1.3); 3.8507 (1.4); 3.8441 (1.7); 3.8264 (1.9);
3.8040 (1.7); 3.7813 (1.1); 3.7738 (1.2); 3.7565 (1.0); 3.7504 (0.7); 3.7334 (0.6); 1.8583 (15.3);
1.8365 (15.3); 1.7772 (15.9); 1.7554 (15.0); 1.6136 (4.2); 1.5819 (0.3); 1.5611 (0.4); 1.2942 (5.3);
0.9406 (1.4); 0.9190 (3.8); 0.8957 (1.6); 0.1102 (1.7); 0.0479 (0.5); 0.0373 (8.7); 0.0265 (0.5)
I-553: ¹H-NMR(400.1 MHz, d₆-DMSO):
δ = 9.0984 (0.9); 9.0840 (2.0); 9.0693 (1.1); 8.6130 (4.0); 8.5796 (2.3); 8.5672 (2.4); 8.1087 (6.7);
7.9606 (3.0); 7.7913 (0.7); 7.7716 (2.1); 7.7522 (2.0); 7.7284 (5.2); 7.7074 (1.6); 7.6611 (2.0); 7.6359
(4.4); 7.5910 (2.6); 7.5699 (3.1); 7.5169 (2.8); 7.5045 (2.9); 7.3765 (1.9); 7.3722 (1.9); 7.3556 (1.7);
7.3512 (1.7); 6.0965 (0.6); 6.0841 (1.2); 6.0715 (0.7); 5.9810 (0.6); 5.9687 (1.2); 5.9562 (0.7); 3.9440
(1.0); 3.9301 (1.9); 3.9164 (1.2); 3.8865 (1.1); 3.8731 (1.8); 3.8595 (1.2); 3.3245 (55.0); 2.8985
(16.0); 2.7394 (15.1); 2.5092 (14.2); 2.3563 (15.3)
I-554: ¹H-NMR(300.2 MHz, CDCl3):
δ = 7.5857 (0.4); 7.5595 (3.1); 7.5540 (2.9); 7.5491 (2.9); 7.5416 (7.4); 7.5384 (7.7); 7.4616 (3.6);
7.4377 (0.6); 7.4309 (0.5); 7.4233 (1.6); 7.4111 (2.2); 7.4043 (1.9); 7.3847 (4.3); 7.3581 (3.9); 7.2985
(11.7); 7.0691 (4.0); 6.9925 (2.2); 6.9656 (1.9); 6.6283 (1.0); 6.6083 (1.9); 6.5877 (1.0); 5.3365
(14.2); 4.4586 (0.7); 4.4494 (1.3); 4.4386 (1.9); 4.4291 (2.7); 4.4194 (1.8); 4.4087 (1.4); 4.3994 (0.7);
4.2672 (1.8); 4.2467 (1.7); 4.2173 (3.8); 4.1968 (3.6); 4.1674 (2.0); 4.1468 (1.8); 2.9789 (0.6); 2.8867
(0.6); 2.4996 (12.0); 2.4928 (6.9); 2.3183 (16.0); 2.0775 (0.4); 2.0378 (0.5); 1.6085 (1.4); 1.2940
(0.4); 0.9885 (0.8); 0.9789 (1.0); 0.9704 (2.4); 0.9617 (4.9); 0.9561 (4.2); 0.9471 (2.3); 0.9358 (1.4);
0.8866 (0.5); 0.8832 (0.5); 0.8778 (0.4); 0.8631 (0.4); 0.8285 (1.2); 0.8250 (1.2); 0.8060 (4.0); 0.7997
(2.6); 0.7927 (2.0); 0.7855 (3.1); 0.7792 (3.0); 0.7612 (0.7); 0.7578 (0.6); 0.1091 (0.9); 0.0491 (0.4);
0.0384 (11.3); 0.0274 (0.5)
I-555: ¹H-NMR(300.2 MHz, CDCl3):
δ = 7.5839 (2.3); 7.5819 (2.4); 7.3926 (0.3); 7.3652 (6.6); 7.3608 (3.4); 7.3481 (1.3); 7.3320 (0.4);
7.3218 (2.6); 7.2986 (10.7); 7.1463 (0.4); 7.0142 (1.4); 6.9911 (2.0); 6.9882 (2.2); 6.9836 (2.1);
6.9645 (0.9); 6.9613 (0.9); 6.9565 (1.2); 6.9535 (0.9); 6.9064 (1.7); 6.9002 (2.1); 6.8934 (1.2); 6.6250
(0.5); 6.6057 (0.9); 6.5854 (0.5); 6.0620 (0.5); 6.0516 (0.6); 6.0397 (0.6); 6.0293 (0.5); 5.9073 (0.5);
5.8967 (0.6); 5.8849 (0.6); 5.8744 (0.5); 4.1858 (0.4); 4.1751 (0.4); 4.1639 (0.4); 4.1532 (0.4); 4.1484
(0.3); 4.0993 (0.4); 4.0886 (0.3); 4.0774 (0.3); 3.9551 (0.3); 3.9344 (0.5); 3.9131 (0.4); 3.8838 (0.4);
3.8790 (0.4); 3.8588 (0.5); 3.8369 (0.4); 3.8301 (0.3); 3.8102 (0.5); 3.7888 (0.4); 2.4083 (16.0);
1.9618 (0.5); 1.9507 (0.6); 1.9339 (1.1); 1.9173 (0.7); 1.9061 (0.6); 1.5982 (6.3); 1.3048 (1.8); 1.0398
(0.7); 1.0247 (2.0); 1.0179 (2.1); 1.0121 (1.2); 1.0030 (1.4); 0.9963 (2.2); 0.9898 (1.8); 0.9751 (1.0);
0.9417 (0.7); 0.9200 (2.0); 0.8968 (0.7); 0.7588 (1.0); 0.7436 (2.5); 0.7376 (2.1); 0.7271 (2.1); 0.7216
(2.5); 0.7052 (0.8); 0.1078 (0.8); 0.0487 (0.4); 0.0380 (9.8); 0.0270 (0.4)
I-556: ¹H-NMR(300.2 MHz, CDCl3):
δ = 7.4620 (2.2); 7.4342 (4.4); 7.4252 (2.1); 7.3248 (1.3); 7.2987 (14.6); 7.2723 (1.7); 7.2292 (1.8);
7.2223 (1.6); 7.2014 (1.4); 7.1944 (1.3); 6.9864 (1.6); 6.9790 (2.9); 6.9512 (2.9); 6.9103 (2.0); 6.9039
(2.6); 6.8976 (1.3); 6.5313 (0.5); 6.5126 (0.9); 6.4930 (0.5); 6.0839 (0.6); 6.0732 (0.6); 6.0613 (0.6);
6.0511 (0.5); 5.9288 (0.6); 5.9185 (0.6); 5.9063 (0.6); 5.8957 (0.5); 4.2084 (0.4); 4.1937 (0.6); 4.1861
(0.4); 4.1696 (1.7); 4.1586 (0.4); 4.1460 (1.7); 4.1364 (0.4); 4.1213 (0.8); 4.1095 (0.4); 4.0981 (0.4);
4.0875 (0.4); 3.9428 (0.4); 3.9210 (0.5); 3.9011 (0.4); 3.8943 (0.4); 3.8684 (0.6); 3.8486 (0.6); 3.8261
(0.4); 3.8192 (0.4); 3.7970 (0.4); 2.6280 (16.0); 2.4486 (0.5); 2.3189 (16.0); 2.0815 (6.0); 1.9531
(0.6); 1.9418 (0.7); 1.9252 (1.3); 1.9083 (0.7); 1.8972 (0.7); 1.8800 (0.4); 1.6053 (6.3); 1.3202 (1.6);
1.2964 (3.2); 1.2726 (1.5); 1.0217 (0.8); 1.0060 (2.1); 0.9996 (2.3); 0.9849 (1.2); 0.9779 (2.3); 0.9713
(2.0); 0.9571 (1.0); 0.7548 (1.0); 0.7394 (2.6); 0.7336 (2.4); 0.7233 (2.2); 0.7171 (2.8); 0.7012 (0.8);
0.0484 (0.4); 0.0377 (11.8); 0.0270 (0.5)
I-557: ¹H-NMR(400.1 MHz, d₆-DMSO):
δ = 9.0057 (1.7); 8.9850 (1.8); 7.9601 (0.5); 7.6502 (2.1); 7.6305 (2.3); 7.4756 (1.3); 7.4553 (3.1);
7.4349 (2.0); 7.3992 (2.2); 7.3786 (2.6); 7.3220 (1.8); 7.3192 (1.8); 7.2991 (1.5); 7.2759 (4.9); 7.2302
(2.0); 7.2251 (3.4); 7.2201 (2.0); 7.1495 (2.7); 7.1302 (3.2); 7.1125 (1.3); 6.9134 (1.3); 6.8944 (2.2);
6.8761 (1.2); 5.4683 (0.9); 5.4501 (1.3); 5.4320 (0.9); 3.7168 (16.0); 3.3402 (77.7); 2.8974 (3.0);
2.7386 (2.8); 2.5304 (14.4); 2.5131 (7.0); 2.5092 (8.9); 2.5053 (6.9); 2.2270 (14.2); 1.5864 (6.1);
1.5695 (6.2)
I-558: ¹H-NMR(300.2 MHz, CDCl3):
δ = 9.2308 (1.6); 9.1825 (7.3); 8.3910 (13.3); 8.0233 (3.0); 7.9961 (3.5); 7.8767 (2.4); 7.8494 (4.2);
7.7892 (2.1); 7.7854 (2.0); 7.7664 (3.2); 7.7625 (3.4); 7.7389 (8.5); 7.7076 (4.8); 7.6809 (3.0); 7.6775
(3.1); 7.6540 (16.0); 7.6446 (5.3); 7.6326 (2.5); 7.6154 (0.6); 7.6097 (0.5); 7.3038 (13.3); 5.0190
(8.2); 5.0029 (8.2); 1.6593 (10.0); 1.2980 (0.4); 0.1137 (0.6); 0.0526 (0.5); 0.0418 (13.5); 0.0309 (0.5)
I-559: ¹H-NMR(300.2 MHz, CDCl3):
δ = 9.3197 (6.0); 8.6041 (5.0); 8.5841 (5.3); 8.3798 (0.4); 8.3722 (16.0); 8.0208 (4.3); 7.9934 (3.8);
7.8817 (4.1); 7.8617 (3.8); 7.7892 (2.6); 7.7686 (3.5); 7.6512 (3.7); 7.6273 (3.3); 7.6240 (3.8); 7.6131
(0.8); 7.6099 (0.8); 7.5962 (7.2); 7.5927 (8.6); 7.5835 (3.0); 7.5725 (3.7); 7.5463 (0.8); 7.3914 (3.6);
7.3889 (3.3); 7.3443 (1.6); 7.3374 (2.1); 7.3286 (1.1); 7.3226 (2.1); 7.3154 (2.4); 7.3062 (1.3); 7.3049
(1.4); 7.2987 (13.8); 7.2895 (0.4); 5.3346 (1.9); 5.2059 (7.8); 5.1868 (7.7); 1.6810 (3.4); 1.2908 (0.4);
0.0463 (0.4); 0.0355 (11.5); 0.0246 (0.4)
I-560: ¹H-NMR(400.0 MHz, d₆-DMSO):
δ = 8.7800 (0.6); 8.7662 (1.1); 8.7518 (0.6); 8.0688 (5.7); 7.9993 (2.0); 7.9937 (2.1); 7.9539 (0.3);
7.7524 (0.4); 7.7327 (1.3); 7.7128 (1.5); 7.6965 (2.8); 7.6910 (2.3); 7.6034 (1.2); 7.5833 (0.9); 7.5773
(1.6); 7.5709 (1.2); 7.5559 (1.3); 7.5497 (1.2); 6.5529 (2.2); 6.5319 (2.1); 5.1233 (0.4); 5.1079 (1.1);
5.0924 (1.5); 5.0770 (1.2); 5.0615 (0.4); 3.5384 (0.7); 3.5219 (1.9); 3.5069 (2.0); 3.4905 (0.8); 3.3495
(59.7); 2.8926 (2.2); 2.7804 (1.3); 2.7637 (2.7); 2.7470 (1.2); 2.7338 (2.1); 2.5136 (6.9); 2.5096
(14.2); 2.5051 (18.9); 2.5007 (13.8); 1.2392 (0.6); 1.2218 (16.0); 1.2063 (15.7); −0.0002 (0.7)
I-561: ¹H-NMR(400.1 MHz, d₆-DMSO):
δ = 9.0588 (0.6); 9.0431 (1.3); 9.0273 (0.7); 7.9611 (0.8); 7.8713 (2.3); 7.8677 (2.4); 7.6063 (5.3);
7.4838 (1.4); 7.4626 (3.1); 7.4295 (1.7); 7.4252 (1.7); 7.4085 (0.9); 7.4041 (0.9); 7.3798 (1.2); 7.3594
(2.4); 7.3393 (1.4); 6.8729 (1.1); 6.8686 (1.2); 6.8532 (1.0); 6.8475 (1.2); 6.7437 (1.2); 6.7384 (2.6);
6.7322 (3.1); 6.7112 (1.4); 6.7063 (1.1); 4.2695 (0.6); 4.2539 (0.7); 4.2350 (1.4); 4.2192 (1.4); 4.2004
(0.8); 4.1845 (0.7); 3.7768 (16.0); 3.3151 (77.1); 2.8993 (5.2); 2.7404 (4.7); 2.5802 (13.3); 2.5138
(7.1); 2.5094 (9.8); 2.5050 (7.4)
I-562: ¹H-NMR(400.1 MHz, d₆-DMSO):
δ = 9.2163 (0.9); 9.2005 (2.0); 9.1846 (1.0); 8.6068 (4.7); 8.5735 (2.6); 8.5611 (2.8); 8.0276 (6.7);
7.9607 (3.0); 7.7930 (0.8); 7.7735 (2.3); 7.7538 (5.6); 7.7295 (2.9); 7.7101 (1.5); 7.6835 (3.4); 7.6222
(2.0); 7.6012 (4.2); 7.5798 (3.3); 7.4950 (2.8); 7.4825 (2.9); 7.2714 (1.8); 7.2674 (1.9); 7.2505 (1.7);
7.2462 (1.8); 4.3394 (0.9); 4.3239 (1.0); 4.3053 (2.0); 4.2899 (2.0); 4.2713 (1.1); 4.2550 (1.0); 3.3242
(113.7); 3.2751 (0.9); 2.8990 (16.0); 2.7398 (15.0); 2.5097 (15.8); 2.3391 (15.8)
I-563: ¹H-NMR(300.2 MHz, CDCl3):
δ = 8.1544 (4.9); 7.9126 (0.7); 7.8933 (0.4); 7.6505 (1.4); 7.6242 (2.1); 7.6003 (1.2); 7.4802 (1.8);
7.4523 (2.5); 7.4314 (2.8); 7.4267 (2.2); 7.4038 (1.2); 7.3767 (0.6); 7.2988 (13.4); 7.2835 (1.6);
7.2767 (1.5); 7.2555 (1.2); 7.2488 (1.1); 6.1495 (0.4); 6.1393 (0.5); 6.1272 (0.5); 6.1166 (0.5); 5.9950
(0.5); 5.9841 (0.5); 5.9723 (0.5); 5.9616 (0.5); 5.3379 (5.3); 4.2965 (0.4); 4.2857 (0.4); 4.2746 (0.3);
4.2633 (0.4); 4.2583 (0.3); 4.2094 (0.4); 4.1985 (0.4); 4.1874 (0.4); 4.1765 (0.3); 3.9565 (0.3); 3.9386
(0.4); 3.9339 (0.4); 3.9162 (0.4); 3.8844 (0.5); 3.8658 (0.6); 3.8606 (0.4); 3.8425 (0.4); 3.8165 (0.3);
2.7660 (15.3); 2.0488 (0.4); 1.6022 (16.0); 1.2913 (0.4); 0.1064 (6.0); 0.0472 (0.6); 0.0364 (14.0);
0.0256 (0.6)
I-564: ¹H-NMR(300.2 MHz, CDCl3):
δ = 7.4336 (1.4); 7.4271 (0.7); 7.4063 (4.1); 7.3871 (1.1); 7.3806 (3.8); 7.2983 (25.5); 7.2569 (1.2);
7.2533 (0.8); 7.2323 (1.8); 7.2075 (0.8); 7.2036 (0.6); 7.1941 (2.7); 7.1902 (3.3); 7.1830 (0.9); 7.1686
(1.5); 7.1651 (2.5); 7.0666 (2.1); 6.9829 (1.1); 6.9572 (1.0); 6.3210 (0.5); 6.3015 (0.8); 6.2814 (0.5);
5.3373 (12.9); 4.2655 (1.0); 4.2452 (0.9); 4.2162 (2.1); 4.1959 (2.0); 4.1668 (1.1); 4.1467 (1.1);
3.7510 (0.5); 3.7438 (0.5); 3.7172 (0.9); 3.6911 (0.5); 3.6830 (0.6); 2.6353 (0.3); 2.6055 (16.0);
2.5106 (6.0); 2.5037 (3.5); 2.4643 (0.4); 2.4580 (0.4); 2.4285 (1.1); 2.4213 (0.9); 2.4000 (1.4); 2.3926
(1.2); 2.3813 (0.6); 2.3727 (0.9); 2.3660 (0.9); 2.3531 (0.6); 2.3447 (0.6); 2.3233 (8.8); 2.2876 (1.3);
2.2811 (1.2); 2.2544 (0.9); 2.2462 (0.7); 2.0827 (0.9); 2.0485 (0.5); 2.0220 (0.8); 1.9870 (0.8); 1.9535
(0.4); 1.8467 (0.4); 1.8168 (0.7); 1.7870 (0.6); 1.5976 (12.5); 1.3208 (0.4); 1.2968 (1.2); 1.1646 (0.5);
1.1438 (0.4); 0.1746 (0.4); 0.1077 (53.4); 0.0954 (2.2); 0.0487 (1.0); 0.0380 (25.2); 0.0271 (0.9)
I-565: ¹H-NMR(300.2 MHz, CDCl3):
δ = 7.9763 (8.4); 7.8553 (0.5); 7.7371 (0.8); 7.7228 (8.3); 7.7080 (0.6); 7.6616 (0.4); 7.6349 (0.4);
7.6064 (4.6); 7.6017 (3.5); 7.5891 (7.4); 7.5656 (0.7); 7.5257 (0.5); 7.4958 (3.7); 7.4748 (0.6); 7.4613
(1.7); 7.4521 (1.6); 7.4469 (2.2); 7.4407 (1.8); 7.4312 (1.4); 7.4230 (1.0); 7.3277 (3.3); 7.2986 (8.8);
7.2759 (0.3); 7.0551 (4.3); 6.9504 (2.2); 6.9243 (1.9); 6.7400 (1.0); 6.7200 (2.0); 6.6997 (1.1); 5.3356
(1.2); 4.1480 (1.7); 4.1275 (1.6); 4.0994 (3.5); 4.0788 (3.4); 4.0507 (1.8); 4.0301 (1.8); 2.5059 (0.3);
2.4649 (11.5); 2.3721 (0.7); 2.3455 (0.5); 2.3006 (16.0); 1.6555 (3.9); 0.1123 (0.5); 0.0400 (5.3)
I-566: ¹H-NMR(300.2 MHz, CDCl3):
δ = 7.3972 (2.0); 7.3706 (2.3); 7.3075 (1.7); 7.2983 (13.9); 7.2817 (2.6); 7.2553 (1.7); 7.0882 (2.3);
7.0046 (1.4); 6.9792 (2.6); 6.9713 (2.8); 6.9642 (2.0); 6.9553 (1.2); 6.9521 (1.3); 6.9442 (2.2); 6.9390
(1.6); 6.8970 (2.0); 6.8907 (2.4); 6.8839 (1.3); 6.4526 (0.5); 6.4318 (1.0); 6.4122 (0.5); 4.2691 (1.1);
4.2482 (1.0); 4.2203 (2.3); 4.1994 (2.2); 4.1713 (1.2); 4.1505 (1.1); 2.6863 (0.3); 2.6198 (16.0);
2.5528 (0.6); 2.5323 (6.7); 2.5255 (3.9); 2.3898 (0.4); 2.3436 (8.9); 2.2657 (15.6); 2.1993 (0.3);
2.0449 (0.4); 1.9435 (0.6); 1.9324 (0.7); 1.9271 (0.5); 1.9155 (1.2); 1.8987 (0.7); 1.8876 (0.7); 1.8708
(0.4); 1.6071 (10.0); 1.2967 (1.4); 1.0149 (0.9); 0.9998 (2.2); 0.9928 (2.4); 0.9871 (1.3); 0.9780 (1.4);
0.9713 (2.3); 0.9646 (2.0); 0.9501 (1.2); 0.9414 (0.6); 0.9196 (1.4); 0.8963 (0.6); 0.7471 (1.1); 0.7320
(2.7); 0.7258 (2.4); 0.7155 (2.3); 0.7097 (2.8); 0.6934 (0.8); 0.1074 (0.5); 0.1041 (0.4); 0.0482 (0.6);
0.0375 (14.2); 0.0266 (0.6)
I-567: ¹H-NMR(300.2 MHz, CDCl3):
δ = 8.2839 (9.2); 7.9537 (0.6); 7.9335 (1.0); 7.9145 (0.6); 7.8542 (0.4); 7.5916 (2.9); 7.5632 (3.6);
7.5268 (2.5); 7.5204 (2.7); 7.3648 (0.4); 7.3342 (1.8); 7.3275 (1.8); 7.3057 (2.0); 7.2984 (20.0);
7.2317 (0.4); 7.2101 (3.5); 7.1813 (4.4); 7.0478 (3.5); 7.0399 (4.2); 6.9755 (2.9); 6.9675 (2.4); 6.9468
(2.3); 6.9387 (1.9); 4.4861 (1.5); 4.4657 (1.4); 4.4375 (3.1); 4.4170 (2.9); 4.4034 (0.4); 4.3887 (1.6);
4.3683 (1.5); 2.0833 (0.4); 1.5881 (16.0); 1.3658 (0.3); 1.3434 (0.6); 1.3033 (3.7); 1.2971 (3.7);
0.9408 (1.3); 0.9189 (4.2); 0.8956 (1.6); 0.1032 (0.4); 0.0477 (0.7); 0.0368 (20.7); 0.0258
(0.8); −0.0298 (0.4)
I-568: ¹H-NMR(400.2 MHz, d₆-DMSO):
δ = 9.0047 (1.2); 8.9912 (2.4); 8.9772 (1.2); 8.3160 (0.3); 8.1277 (16.0); 7.7188 (1.0); 7.7006 (6.7);
7.6801 (5.2); 7.6738 (4.9); 7.6574 (1.0); 7.6542 (1.2); 7.6044 (1.8); 7.6002 (3.0); 7.5959 (1.8); 7.5814
(1.9); 7.2664 (0.5); 7.2601 (4.4); 7.2546 (1.6); 7.2412 (5.0); 7.2381 (6.4); 7.2256 (1.7); 7.2201 (4.9);
6.9315 (2.4); 6.9293 (2.0); 6.9145 (10.2); 6.9125 (10.3); 6.8930 (10.9); 4.1284 (3.6); 4.1147 (7.9);
4.1011 (4.1); 3.9026 (0.9); 3.7022 (2.1); 3.6886 (5.6); 3.6747 (5.4); 3.6608 (1.8); 3.3297 (180.6);
2.6756 (0.9); 2.6711 (1.2); 2.6666 (0.9); 2.5245 (4.2); 2.5196 (6.9); 2.5111 (80.0); 2.5067 (158.5);
2.5022 (205.0); 2.4976 (148.2); 2.4931 (73.0); 2.3380 (0.5); 2.3335 (0.9); 2.3289 (1.2); 2.3244
(0.9); −0.0002 (1.0)
I-569: ¹H-NMR(499.9 MHz, CDCl3):
δ = 7.5401 (2.5); 7.5366 (2.7); 7.5298 (5.3); 7.5189 (1.6); 7.5060 (1.3); 7.4891 (0.6); 7.4169 (2.6);
7.3642 (0.9); 7.3567 (1.3); 7.3533 (1.2); 7.3463 (1.0); 7.3418 (0.7); 7.2606 (4.5); 6.9104 (0.6); 6.8927
(1.2); 6.8717 (0.7); 6.8520 (0.7); 6.8351 (1.3); 6.8192 (0.7); 6.6784 (0.7); 6.6660 (1.2); 6.6537 (0.7);
4.2920 (1.0); 4.2792 (1.0); 4.2631 (2.1); 4.2503 (2.1); 4.2341 (1.1); 4.2213 (1.0); 2.3305 (16.0);
1.5707 (9.1); 1.2567 (0.4); −0.0002 (3.7)
I-570: ¹H-NMR(400.0 MHz, d₆-DMSO):
δ = 9.1830 (1.1); 9.1677 (2.3); 9.1520 (1.1); 7.9378 (11.6); 7.9285 (0.4); 7.4041 (2.0); 7.3845 (4.3);
7.3650 (2.7); 7.3333 (3.5); 7.3133 (3.9); 7.1666 (2.7); 7.1474 (2.3); 7.0902 (4.2); 7.0594 (4.2); 7.0425
(2.5); 7.0226 (2.0); 7.0180 (1.6); 6.9661 (2.2); 6.9463 (2.1); 4.1194 (1.2); 4.1038 (1.2); 4.0824 (2.6);
4.0666 (2.5); 4.0450 (1.3); 4.0295 (1.2); 3.3483 (16.5); 2.8976 (1.5); 2.7390 (1.3); 2.6862 (1.8);
2.6673 (5.2); 2.6483 (5.3); 2.6293 (1.8); 2.5179 (17.7); 2.5138 (33.7); 2.5093 (43.9); 2.5049 (32.8);
2.4240 (10.8); 2.2672 (0.6); 2.2405 (15.2); 2.1957 (0.5); 1.2275 (7.7); 1.2086 (16.0); 1.1896 (7.3)
I-571: ¹H-NMR(400.1 MHz, CDCl3):
δ = 8.2740 (5.7); 7.6072 (4.3); 7.5925 (2.6); 7.5732 (0.6); 7.3934 (2.1); 7.3032 (0.8); 7.2979 (1.1);
7.2879 (1.1); 7.2824 (1.2); 7.2750 (0.8); 7.2595 (12.9); 6.9725 (2.2); 6.9521 (2.3); 6.3545 (2.5);
6.3487 (2.6); 6.1831 (1.5); 6.1772 (1.4); 6.1625 (1.4); 6.1567 (1.3); 3.7801 (1.2); 3.7653 (2.4); 3.7491
(2.4); 3.7344 (1.2); 3.6994 (15.4); 3.6732 (16.0); 2.9027 (1.9); 2.8865 (3.1); 2.8704 (1.7); 1.5443
(10.2); −0.0002 (12.3)
I-572: ¹H-NMR(300.2 MHz, CDCl3):
δ = 7.5676 (0.3); 7.5419 (1.3); 7.5163 (3.5); 7.5113 (1.8); 7.4924 (0.4); 7.4396 (2.0); 7.4364 (1.6);
7.4219 (1.0); 7.4139 (1.5); 7.4062 (2.2); 7.3910 (0.9); 7.3796 (2.0); 7.2986 (6.6); 7.0922 (1.8); 7.0105
(1.0); 6.9839 (0.9); 6.3776 (0.4); 6.3572 (0.8); 6.3372 (0.4); 4.3003 (0.9); 4.2794 (0.9); 4.2514 (1.9);
4.2305 (1.8); 4.2025 (1.0); 4.1816 (0.9); 2.5375 (5.6); 2.5306 (3.2); 2.4307 (16.0); 2.3689 (0.4);
2.3323 (7.4); 2.1105 (0.6); 2.0997 (0.6); 2.0940 (0.4); 2.0834 (1.2); 2.0725 (0.5); 2.0668 (0.7); 2.0561
(0.6); 1.6068 (5.6); 1.2945 (0.5); 1.2698 (0.9); 1.2671 (0.8); 1.2518 (1.8); 1.2437 (2.1); 1.2357 (1.8);
1.2319 (1.5); 1.2273 (2.0); 1.2155 (0.8); 1.1062 (0.9); 1.0944 (2.0); 1.0858 (1.5); 1.0791 (1.2); 1.0672
(1.9); 1.0585 (1.5); 1.0439 (0.6); 0.1084 (0.5); 0.0376 (5.5)
I-573: ¹H-NMR(400.0 MHz, d₆-DMSO):
δ = 8.7495 (0.6); 8.7356 (1.2); 8.7215 (0.6); 8.0677 (6.1); 7.9530 (0.4); 7.7552 (0.4); 7.7361 (1.3);
7.7156 (1.4); 7.6977 (4.2); 7.6807 (0.8); 7.6015 (1.3); 7.5822 (0.9); 6.7395 (2.4); 6.7350 (2.9); 6.6933
(0.8); 6.6886 (0.7); 6.6728 (2.0); 6.6680 (2.0); 6.6482 (3.9); 6.6278 (1.5); 4.1367 (16.0); 3.5056 (0.8);
3.4887 (2.0); 3.4735 (2.0); 3.4567 (0.8); 3.3454 (29.6); 3.3439 (29.5); 2.8915 (2.8); 2.7326 (3.9);
2.7149 (3.0); 2.6974 (1.4); 2.5127 (4.8); 2.5086 (10.1); 2.5041 (13.5); 2.4997 (9.9); 2.4955 (4.9);
1.2388 (0.4); −0.0002 (0.9)
I-574: ¹H-NMR(400.1 MHz, d₆-DMSO):
δ = 9.0484 (1.6); 9.0327 (3.3); 9.0168 (1.6); 7.9609 (2.5); 7.8710 (5.8); 7.8679 (6.0); 7.6027 (13.0);
7.4777 (3.5); 7.4564 (7.7); 7.4251 (4.4); 7.4210 (4.3); 7.4041 (2.0); 7.3999 (2.0); 7.3386 (2.8); 7.3189
(5.9); 7.2992 (3.5); 6.9922 (3.6); 6.9726 (3.3); 6.9168 (2.6); 6.9118 (3.1); 6.8967 (2.3); 6.8928 (3.0);
6.8657 (4.4); 6.8614 (5.9); 4.2677 (1.5); 4.2517 (1.6); 4.2331 (3.5); 4.2172 (3.4); 4.1985 (1.8); 4.1826
(1.6); 3.3142 (192.8); 2.8992 (16.0); 2.7401 (14.4); 2.5756 (32.7); 2.5509 (0.4); 2.5136 (19.7); 2.5093
(26.8); 2.5049 (19.8); 1.9989 (0.6); 1.9860 (1.3); 1.9776 (1.5); 1.9653 (2.7); 1.9528 (1.6); 1.9445
(1.5); 1.9317 (0.8); 1.0079 (1.6); 0.9969 (4.7); 0.9915 (5.1); 0.9812 (2.5); 0.9760 (4.9); 0.9707 (4.9);
0.9604 (1.8); 0.7100 (1.8); 0.6993 (5.6); 0.6945 (5.6); 0.6870 (5.2); 0.6821 (5.8); 0.6708 (1.6)
I-575: ¹H-NMR(400.1 MHz, d₆-DMSO):
δ = 9.1722 (0.9); 9.1567 (2.0); 9.1415 (1.0); 8.6089 (4.8); 8.5752 (2.7); 8.5628 (2.9); 8.0675 (6.9);
7.9606 (2.6); 7.7938 (0.7); 7.7742 (2.1); 7.7547 (2.1); 7.7300 (2.9); 7.7094 (4.8); 7.6826 (0.4); 7.6370
(2.0); 7.6170 (1.6); 7.5801 (2.8); 7.5591 (6.4); 7.5272 (6.3); 7.5049 (5.6); 7.4916 (3.3); 4.1877 (0.8);
4.1720 (1.0); 4.1533 (1.9); 4.1377 (2.0); 4.1186 (1.1); 4.1029 (1.0); 3.3254 (124.2); 2.8986 (14.2);
2.7395 (13.3); 2.5094 (16.6); 2.3462 (16.0)
I-576: ¹H-NMR(400.2 MHz, d₆-DMSO):
δ = 9.1064 (0.4); 9.0909 (0.8); 9.0755 (1.3); 9.0594 (0.6); 8.3102 (1.5); 7.7324 (0.8); 7.7129 (2.0);
7.6934 (1.8); 7.6813 (0.4); 7.6605 (6.3); 7.6475 (1.2); 7.6339 (0.8); 7.6262 (1.4); 7.5915 (2.4); 7.5729
(3.4); 7.5535 (3.0); 7.5431 (0.8); 7.5230 (1.9); 7.5045 (1.1); 7.2673 (1.4); 7.2440 (1.4); 7.2210 (0.3);
4.9624 (0.5); 4.8946 (2.7); 4.8794 (3.1); 4.8738 (3.1); 4.8587 (3.0); 4.5462 (0.4); 4.5144 (2.8); 4.4986
(4.9); 4.4828 (2.9); 4.2889 (0.8); 4.2726 (0.8); 4.2532 (1.6); 4.2372 (1.8); 4.2181 (1.5); 4.1997 (1.6);
4.1804 (0.6); 3.7184 (0.3); 3.6327 (0.4); 3.6184 (0.6); 3.6040 (0.4); 3.3239 (353.6); 3.2730 (0.4);
3.2672 (0.4); 3.2162 (1.2); 2.7118 (0.7); 2.6760 (1.4); 2.6716 (1.9); 2.6672 (1.4); 2.6029 (1.0); 2.5811
(16.0); 2.5611 (0.6); 2.5418 (166.3); 2.5249 (5.5); 2.5200 (8.4); 2.5114 (116.4); 2.5071 (229.6);
2.5026 (299.0); 2.4981 (219.5); 2.4939 (109.6); 2.4119 (1.0); 2.3681 (0.8); 2.3339 (1.4); 2.3294 (1.9);
2.3249 (1.4); 2.2952 (0.5); 1.3428 (0.4); −0.0002 (3.3)
I-577: ¹H-NMR(499.9 MHz, CDCl3):
δ = 8.3524 (7.7); 7.8845 (1.5); 7.7366 (0.3); 7.7245 (0.7); 7.7111 (0.8); 7.6993 (0.4); 7.6437 (0.3);
7.6268 (4.7); 7.6169 (6.6); 7.4839 (3.6); 7.4441 (0.4); 7.4362 (1.3); 7.4274 (2.0); 7.4240 (1.8); 7.4185
(1.5); 7.4134 (1.1); 7.3544 (0.4); 7.3381 (0.6); 7.3262 (3.6); 7.3104 (3.7); 7.2678 (0.8); 7.2587 (10.4);
7.2384 (0.6); 7.2131 (0.4); 7.0339 (4.2); 6.9391 (2.2); 6.9234 (2.1); 5.2965 (4.5); 4.2508 (1.6); 4.2390
(1.6); 4.2220 (3.4); 4.2102 (3.4); 4.1932 (1.8); 4.1814 (1.8); 3.4203 (8.0); 2.4716 (11.5); 2.3221 (0.7);
2.2777 (16.0); 1.5511 (5.1); 1.2564 (0.9); −0.0002 (9.8); −0.5243 (2.7)
I-578: ¹H-NMR(400.1 MHz, CDCl3):
δ = 8.7046 (0.6); 8.4073 (0.5); 8.2977 (5.7); 8.0171 (0.5); 7.8750 (1.9); 7.8680 (2.0); 7.6507 (2.0);
7.6288 (2.3); 7.4904 (1.0); 7.4885 (1.0); 7.4703 (1.3); 7.4685 (1.4); 7.3628 (1.4); 7.3425 (2.6); 7.3226
(2.6); 7.3181 (2.6); 7.3131 (1.6); 7.2736 (1.4); 7.2663 (1.6); 7.2598 (11.3); 7.2521 (1.6); 7.2446 (1.4);
7.1479 (1.2); 7.1440 (1.1); 7.1423 (1.1); 7.1274 (1.0); 7.1236 (0.9); 4.4407 (1.0); 4.4258 (1.0); 4.4091
(2.0); 4.3941 (2.0); 4.3772 (1.0); 4.3623 (0.9); 3.7928 (16.0); 3.7819 (1.5); 2.9545 (3.8); 2.8823 (3.5);
1.5547 (3.3); 0.0078 (0.6); −0.0002 (13.9); −0.0081 (0.6)
I-579: ¹H-NMR(400.1 MHz, d₆-DMSO):
δ = 9.1158 (1.4); 9.1000 (2.8); 9.0841 (1.4); 7.9612 (2.5); 7.8691 (5.0); 7.8656 (5.2); 7.6786 (0.3);
7.6449 (11.2); 7.5071 (3.4); 7.4859 (6.1); 7.4385 (3.4); 7.4343 (3.3); 7.4175 (1.9); 7.4133 (1.9);
7.1881 (1.3); 7.1680 (3.5); 7.1483 (2.8); 7.1210 (1.7); 7.1170 (2.0); 7.0995 (2.5); 7.0828 (1.1); 7.0790
(1.0); 6.9435 (1.4); 6.9399 (1.4); 6.9243 (2.5); 6.9075 (1.3); 4.2881 (1.3); 4.2728 (1.4); 4.2542 (3.0);
4.2383 (2.9); 4.2196 (1.5); 4.2036 (1.4); 3.3146 (181.3); 2.8992 (16.0); 2.7401 (14.3); 2.5781 (27.7);
2.5137 (17.7); 2.5093 (24.2); 2.5049 (18.0); 2.1067 (0.5); 2.0938 (1.0); 2.0854 (1.2); 2.0728 (2.0);
2.0602 (1.2); 2.0518 (1.1); 2.0389 (0.6); 1.0503 (1.2); 1.0392 (3.7); 1.0338 (4.0); 1.0236 (2.2); 1.0181
(3.8); 1.0128 (4.0); 1.0027 (1.6); 0.8088 (1.5); 0.7983 (4.3); 0.7937 (4.6); 0.7858 (4.2); 0.7809 (4.6);
0.7695 (1.3)
I-580: ¹H-NMR(400.1 MHz, d₆-DMSO):
δ = 9.0648 (0.8); 9.0502 (1.6); 9.0352 (0.9); 8.6262 (5.1); 8.3881 (2.9); 8.3761 (3.2); 8.2825 (0.4);
8.2480 (6.7); 7.9601 (2.4); 7.7911 (0.6); 7.7713 (2.0); 7.7612 (4.8); 7.7526 (4.2); 7.7301 (2.7); 7.7218
(3.6); 7.7098 (4.0); 7.6650 (1.6); 7.6451 (1.2); 7.4957 (7.6); 6.0893 (0.5); 6.0774 (0.9); 6.0641 (0.5);
5.9747 (0.5); 5.9625 (0.9); 5.9497 (0.6); 4.0095 (16.0); 3.9488 (0.5); 3.9342 (1.1); 3.9203 (1.0);
3.9094 (0.6); 3.8930 (0.6); 3.8780 (1.1); 3.8649 (1.0); 3.8539 (0.6); 3.3420 (138.3); 2.8980 (15.0);
2.7386 (13.5); 2.5141 (9.5); 2.5099 (13.1); 2.5057 (10.3)
I-581: ¹H-NMR(300.2 MHz, CDCl3):
δ = 8.7622 (0.6); 8.2921 (1.5); 8.1408 (5.0); 7.7252 (0.8); 7.7221 (0.8); 7.7186 (0.8); 7.6983 (0.9);
7.6955 (0.9); 7.6919 (0.9); 7.3149 (1.7); 7.2986 (9.9); 7.2880 (1.5); 7.1572 (0.5); 7.1536 (0.4); 7.1303
(1.4); 7.1015 (1.3); 7.0799 (0.9); 7.0735 (1.1); 7.0564 (1.0); 7.0510 (1.2); 7.0297 (0.5); 7.0239 (0.5);
6.8787 (0.7); 6.8725 (0.7); 6.8521 (1.1); 6.8306 (0.6); 6.8252 (0.6); 6.7357 (1.0); 6.5494 (2.1); 6.3631
(1.1); 5.3365 (4.4); 4.0522 (1.0); 4.0330 (2.2); 4.0227 (0.6); 4.0122 (2.2); 3.9925 (1.1); 3.2426 (1.4);
3.2221 (2.1); 3.2020 (1.2); 2.7366 (16.0); 2.1304 (0.4); 2.1190 (0.5); 2.1021 (0.9); 2.0846 (0.5);
2.0737 (0.5); 1.6330 (12.1); 1.0829 (0.7); 1.0677 (1.8); 1.0608 (1.9); 1.0460 (1.0); 1.0391 (1.9);
1.0325 (1.7); 1.0178 (0.8); 0.8237 (0.9); 0.8087 (2.1); 0.8029 (2.0); 0.7919 (1.8); 0.7862 (2.2); 0.7696
(0.6); 0.1059 (5.1); 0.0461 (0.4); 0.0352 (10.2); 0.0244 (0.4)
I-582: ¹H-NMR(400.2 MHz, d₆-DMSO):
δ = 9.0017 (1.4); 8.9802 (1.4); 8.3108 (3.4); 7.8172 (6.4); 7.7165 (0.6); 7.6972 (1.6); 7.6771 (1.3);
7.6353 (2.0); 7.6203 (2.9); 7.5842 (1.3); 7.5618 (1.0); 7.3143 (1.8); 7.2945 (2.1); 7.1217 (2.6); 7.1103
(1.6); 7.0905 (1.2); 5.1837 (0.7); 5.1659 (0.7); 4.9188 (2.5); 4.9044 (2.9); 4.8981 (2.8); 4.8835 (2.8);
4.5595 (1.6); 4.5510 (1.8); 4.5429 (2.2); 4.5344 (2.3); 4.5281 (1.7); 4.5195 (1.6); 4.1953 (0.3); 4.1779
(0.7); 4.1577 (1.2); 4.1401 (0.7); 3.3253 (405.8); 2.7732 (0.5); 2.7587 (1.4); 2.7445 (1.5); 2.6807
(1.1); 2.6763 (2.2); 2.6717 (3.0); 2.6672 (2.2); 2.6630 (1.0); 2.6064 (16.0); 2.5864 (0.4); 2.5421 (2.1);
2.5251 (9.5); 2.5203 (14.9); 2.5117 (183.6); 2.5073 (366.2); 2.5027 (479.1); 2.4982 (347.3); 2.4937
(168.3); 2.3386 (1.0); 2.3341 (2.1); 2.3296 (2.9); 2.3250 (2.1); 2.3206 (1.0); 2.0727 (3.1); 2.0284
(0.3); 2.0022 (0.5); 1.9938 (0.6); 1.9708 (0.4); 1.9096 (0.4); 1.8851 (0.5); 1.8649 (0.5); 1.7816 (0.9);
1.7639 (1.3); 1.7540 (1.0); 1.7409 (0.9); −0.0001 (2.5)
I-583: ¹H-NMR(400.2 MHz, d₆-DMSO):
δ = 9.3932 (1.1); 9.3780 (2.2); 9.3630 (1.1); 8.3164 (0.4); 8.2205 (16.0); 7.7539 (0.9); 7.7344 (3.0);
7.7141 (10.2); 7.6989 (4.0); 7.6945 (2.6); 7.6893 (2.2); 7.6839 (2.0); 7.6699 (2.7); 7.6445 (2.6);
7.6399 (1.6); 7.6246 (1.6); 7.6195 (1.6); 7.6143 (1.6); 7.5944 (3.1); 7.5698 (2.7); 7.5508 (3.0); 7.5317
(1.0); 4.6487 (5.6); 4.6336 (5.6); 3.9027 (1.4); 3.3267 (116.1); 2.6798 (0.5); 2.6756 (1.0); 2.6711
(1.4); 2.6665 (1.0); 2.6621 (0.5); 2.5413 (0.9); 2.5245 (5.0); 2.5197 (7.7); 2.5111 (88.6); 2.5067
(176.0); 2.5021 (226.8); 2.4975 (161.9); 2.4930 (78.1); 2.3378 (0.4); 2.3334 (0.9); 2.3289 (1.3);
2.3244 (0.9); 2.3198 (0.4); 1.2358 (0.3); −0.0002 (1.1)
I-584: ¹H-NMR(300.2 MHz, CDCl3):
δ = 8.3947 (13.5); 8.2842 (2.8); 8.1211 (0.4); 7.9864 (1.1); 7.9687 (1.8); 7.7166 (0.5); 7.6893 (4.3);
7.6718 (9.2); 7.6689 (8.3); 7.5582 (4.3); 7.5035 (1.2); 7.4894 (1.7); 7.4768 (3.9); 7.4689 (5.4); 7.4404
(6.8); 7.4100 (5.5); 7.3323 (3.5); 7.3041 (74.2); 6.9530 (0.3); 5.3438 (4.9); 4.4044 (8.8); 4.3221 (2.2);
4.3016 (2.2); 4.2730 (5.0); 4.2529 (4.8); 4.2239 (3.1); 4.2039 (2.8); 4.1717 (0.5); 4.1522 (0.7); 3.4736
(14.1); 3.4284 (3.0); 3.1743 (2.7); 3.1660 (10.6); 2.5589 (10.9); 2.5517 (16.0); 2.0891 (0.8); 2.0518
(5.5); 1.5955 (81.4); 1.3619 (0.7); 1.3255 (0.9); 1.2984 (2.4); 0.9245 (0.6); 0.8976 (0.4); 0.2387 (0.3);
0.1123 (1.9); 0.0534 (2.9); 0.0426 (72.1); 0.0317 (2.6)
I-585: ¹H-NMR(400.1 MHz, CDCl3):
δ = 9.0650 (2.3); 9.0538 (2.3); 8.5377 (5.8); 8.3488 (16.0); 7.7004 (5.9); 7.6338 (0.6); 7.5975 (12.6);
7.5788 (4.3); 7.5724 (4.0); 7.5620 (1.4); 7.5548 (1.7); 7.2597 (17.6); 5.1269 (0.9); 5.1150 (1.7);
5.1016 (1.8); 5.0885 (1.8); 5.0754 (0.9); 2.9678 (3.4); 2.9526 (5.5); 2.9300 (3.6); 2.9178 (2.0); 2.9073
(1.5); 2.8976 (2.0); 2.8843 (3.2); 2.8740 (0.7); 2.0826 (1.5); 2.0644 (3.1); 2.0519 (4.1); 2.0380 (3.3);
2.0234 (1.4); 2.0131 (0.8); 1.7403 (0.9); 1.7177 (1.1); 1.7134 (1.2); 1.7082 (1.2); 1.7002 (1.2); 1.6914
(1.7); 1.6818 (1.4); 1.6736 (1.2); 1.6681 (1.3); 1.6580 (1.2); 1.6416 (1.2); 1.6207 (0.9); 1.4319
(1.1); −0.0002 (5.0)
I-586: ¹H-NMR(400.1 MHz, CDCl3):
δ = 8.2672 (16.0); 8.0157 (2.0); 7.6332 (1.6); 7.4803 (2.7); 7.4783 (2.8); 7.4763 (2.6); 7.4602 (3.6);
7.4582 (3.7); 7.3465 (3.9); 7.3261 (7.1); 7.3059 (3.5); 7.2718 (4.2); 7.2666 (7.2); 7.2594 (33.2);
7.0684 (3.1); 7.0646 (3.0); 7.0627 (2.9); 7.0495 (2.5); 7.0478 (2.7); 7.0440 (2.6); 6.7315 (3.1); 6.7272
(3.5); 6.7116 (4.1); 6.7074 (4.6); 6.6508 (2.3); 6.6467 (2.6); 6.6321 (4.8); 6.6281 (4.1); 6.5951 (5.4);
6.5757 (6.0); 6.5566 (2.4); 4.2084 (2.6); 4.2040 (5.0); 4.1994 (4.0); 4.1945 (6.7); 4.1906 (9.7); 4.1768
(9.6); 4.1730 (7.0); 4.1683 (4.1); 4.1636 (5.1); 4.1592 (2.8); 3.8102 (2.6); 3.7948 (5.8); 3.7785 (5.8);
3.7636 (2.8); 2.9538 (16.0); 2.9410 (5.0); 2.9244 (8.3); 2.9081 (4.6); 2.8818 (14.3); 1.5526 (12.4);
0.0078 (1.4); −0.0002 (39.6); −0.0083 (1.9)
I-587: ¹H-NMR(400.1 MHz, d₆-DMSO):
δ = 9.1806 (1.5); 9.1651 (3.1); 9.1493 (1.5); 7.9610 (2.7); 7.9485 (14.4); 7.7596 (5.2); 7.7552 (5.4);
7.5673 (4.8); 7.5460 (5.5); 7.3623 (2.6); 7.3426 (5.5); 7.3229 (3.2); 7.2681 (3.0); 7.2635 (3.0); 7.2470
(2.6); 7.2422 (2.6); 7.0315 (3.4); 7.0116 (3.0); 6.9575 (2.6); 6.9534 (2.9); 6.9373 (2.2); 6.9333 (2.7);
6.8965 (4.0); 6.8920 (5.5); 4.2868 (1.5); 4.2711 (1.6); 4.2524 (3.3); 4.2366 (3.2); 4.2177 (1.7); 4.2018
(1.6); 3.3139 (159.6); 2.8991 (16.0); 2.7401 (14.4); 2.5135 (16.8); 2.5092 (22.7); 2.5049 (16.8);
2.0073 (0.6); 1.9943 (1.2); 1.9860 (1.4); 1.9736 (2.5); 1.9610 (1.5); 1.9527 (1.4); 1.9398 (0.7); 1.0145
(1.5); 1.0035 (4.4); 0.9981 (4.8); 0.9877 (2.4); 0.9826 (4.6); 0.9773 (4.5); 0.9670 (1.7); 0.7156 (1.7);
0.7047 (5.2); 0.7001 (5.2); 0.6925 (4.9); 0.6876 (5.4); 0.6763 (1.5)
I-588: ¹H-NMR(400.1 MHz, d₆-DMSO):
δ = 9.0499 (0.8); 9.0353 (1.6); 9.0201 (0.9); 8.6250 (5.0); 8.3877 (2.8); 8.3757 (3.1); 8.2507 (6.8);
7.9605 (2.4); 7.7880 (0.6); 7.7685 (1.8); 7.7475 (4.0); 7.7237 (4.8); 7.7111 (3.7); 7.6629 (1.6); 7.6407
(3.9); 7.5820 (2.3); 7.5610 (2.9); 7.3782 (1.7); 7.3734 (1.7); 7.3573 (1.5); 7.3524 (1.4); 6.1043 (0.5);
6.0920 (0.9); 6.0791 (0.5); 5.9892 (0.5); 5.9765 (0.9); 5.9639 (0.6); 4.0088 (16.0); 3.9774 (0.4);
3.9566 (0.6); 3.9407 (1.2); 3.9263 (1.2); 3.9137 (0.6); 3.9012 (0.6); 3.8853 (1.2); 3.8707 (1.1); 3.8587
(0.6); 3.3232 (105.9); 2.8985 (14.1); 2.7395 (12.9); 2.5132 (9.0); 2.5092 (12.2); 2.5050 (9.4)
I-589: ¹H-NMR(601.6 MHz, CD3CN):
δ = 9.2049 (1.2); 8.2135 (16.0); 7.8156 (1.3); 7.7086 (1.5); 7.6955 (4.3); 7.6822 (3.9); 7.6664 (5.4);
7.6533 (2.3); 7.6443 (1.4); 7.6312 (0.7); 7.6196 (0.4); 7.5903 (4.9); 7.5506 (1.7); 7.5352 (0.5); 7.5202
(2.9); 7.5070 (2.4); 7.4891 (1.1); 7.4828 (6.5); 7.4729 (1.5); 7.4688 (7.2); 7.4615 (2.1); 7.4590 (1.3);
7.4473 (2.6); 7.4444 (5.0); 7.4422 (5.8); 7.4413 (5.8); 7.4391 (4.9); 7.4324 (1.9); 7.4303 (1.8); 7.4271
(1.4); 7.2509 (4.0); 7.2474 (3.9); 7.2369 (3.8); 7.2335 (3.6); 7.2260 (0.5); 7.2226 (0.6); 7.2199 (0.5);
7.2118 (0.4); 7.2085 (0.4); 7.2034 (1.1); 7.2000 (1.0); 7.1895 (1.0); 7.1860 (0.9); 7.1320 (0.5); 7.0672
(0.8); 7.0487 (4.1); 6.9778 (1.8); 6.9583 (7.8); 6.8885 (0.9); 6.8680 (3.8); 6.0730 (1.4); 6.0661 (1.6);
6.0631 (1.6); 6.0563 (1.5); 6.0304 (0.5); 6.0238 (0.6); 6.0209 (0.6); 6.0141 (0.5); 5.9967 (1.4); 5.9899
(1.6); 5.9868 (1.7); 5.9800 (1.5); 5.9542 (0.4); 5.9476 (0.5); 5.9446 (0.6); 5.9379 (0.5); 4.0246 (0.8);
4.0178 (0.9); 4.0142 (1.0); 4.0075 (1.0); 4.0005 (1.4); 3.9937 (1.4); 3.9901 (1.6); 3.9881 (1.3); 3.9833
(1.7); 3.9777 (1.3); 3.9710 (1.1); 3.9638 (1.5); 3.9570 (1.4); 3.9534 (1.4); 3.9508 (0.6); 3.9466 (1.4);
3.9402 (0.8); 3.9363 (1.4); 3.9295 (0.9); 3.9262 (2.5); 3.9193 (0.6); 3.9160 (1.5); 3.9122 (0.9); 3.9049
(0.6); 3.9020 (1.6); 3.8989 (1.6); 3.8949 (0.5); 3.8916 (1.2); 3.8886 (2.7); 3.8784 (1.4); 3.8747 (1.1);
3.8645 (1.6); 3.8544 (0.8); 3.5400 (0.4); 2.3743 (0.8); 2.1284 (169.7); 2.0262 (0.4); 2.0221 (0.5);
2.0180 (0.3); 1.9358 (3.0); 1.9277 (1.9); 1.9235 (2.4); 1.9197 (25.4); 1.9156 (46.7); 1.9115 (69.1);
1.9074 (48.2); 1.9033 (25.3); 1.7968 (0.4); 1.5046 (0.3); 1.2430 (1.2)
I-590: ¹H-NMR(300.2 MHz, CDCl3):
δ = 7.5655 (1.7); 7.5397 (2.7); 7.5165 (1.6); 7.4768 (2.2); 7.4488 (2.8); 7.4325 (1.9); 7.4279 (2.4);
7.4222 (1.9); 7.3555 (1.0); 7.3281 (1.4); 7.2986 (6.0); 7.2650 (1.8); 7.2583 (1.7); 7.2371 (1.4); 7.2304
(1.3); 6.5175 (0.5); 6.4977 (0.9); 6.4787 (0.5); 6.1064 (0.5); 6.0958 (0.6); 6.0835 (0.6); 6.0730 (0.5);
5.9513 (0.5); 5.9407 (0.6); 5.9285 (0.6); 5.9179 (0.5); 5.3350 (0.5); 4.2199 (0.4); 4.2091 (0.4); 4.1982
(0.4); 4.1873 (0.4); 4.1816 (0.4); 4.1325 (0.4); 4.1216 (0.4); 4.1108 (0.4); 4.1000 (0.4); 3.9944 (0.4);
3.9744 (0.5); 3.9519 (0.4); 3.9457 (0.3); 3.9216 (0.6); 3.9012 (0.7); 3.8780 (0.4); 3.8717 (0.3); 3.8515
(0.4); 2.6274 (15.6); 2.4494 (0.4); 2.3354 (16.0); 2.0769 (0.4); 1.3033 (0.5); 1.2935 (0.5); 0.9184
(0.5); 0.0364 (3.6)
I-591: ¹H-NMR(400.1 MHz, d₆-DMSO):
δ = 9.2041 (1.7); 9.1830 (1.8); 8.1809 (6.8); 7.9603 (2.5); 7.3602 (3.3); 7.3211 (0.4); 7.2958 (7.4);
7.2751 (0.4); 7.2513 (0.6); 7.2304 (1.6); 7.2093 (1.3); 7.1749 (1.1); 7.1571 (1.6); 7.1382 (0.7); 6.9819
(0.9); 6.9788 (0.9); 6.9622 (1.7); 6.9450 (0.9); 5.1557 (0.4); 5.1398 (0.9); 5.1229 (1.0); 5.1043 (0.4);
3.9050 (16.0); 3.3295 (19.5); 2.8978 (14.4); 2.7893 (0.6); 2.7717 (1.7); 2.7573 (1.8); 2.7384 (13.9);
2.7141 (0.4); 2.5126 (10.5); 2.5088 (13.4); 2.0379 (0.3); 2.0232 (0.5); 2.0119 (0.5); 1.9938 (0.8);
1.9799 (0.5); 1.9053 (0.4); 1.8951 (0.6); 1.8794 (0.6); 1.8619 (0.6); 1.8400 (0.5); 1.8171 (0.8); 1.7975
(1.2); 1.7873 (1.5); 1.7730 (1.1)
I-592: ¹H-NMR(400.2 MHz, d₆-DMSO):
δ = 8.9659 (1.0); 8.9459 (1.1); 8.3108 (16.0); 7.8048 (4.7); 7.7153 (0.5); 7.6947 (1.1); 7.6747 (1.0);
7.6347 (1.4); 7.6182 (2.4); 7.5807 (1.0); 7.5588 (0.8); 7.2358 (1.4); 7.2159 (1.5); 6.9337 (2.3); 6.9106
(1.0); 5.1567 (0.5); 5.1373 (0.6); 3.4867 (0.4); 3.4469 (0.7); 3.4258 (1.0); 3.4039 (1.1); 3.3771 (1.2);
3.3257 (2037.8); 3.2781 (0.8); 2.7237 (0.9); 2.7085 (1.0); 2.6948 (0.7); 2.6805 (4.4); 2.6762 (9.4);
2.6716 (13.0); 2.6670 (9.6); 2.6626 (4.5); 2.6031 (11.9); 2.5251 (40.8); 2.5204 (62.5); 2.5117 (793.6);
2.5072 (1605.9); 2.5027 (2116.2); 2.4981 (1533.9); 2.4935 (743.0); 2.3637 (0.7); 2.3386 (4.6);
2.3340 (9.5); 2.3295 (13.2); 2.3249 (9.6); 2.3204 (4.5); 2.2621 (0.6); 2.2500 (1.0); 2.2440 (1.3);
2.2302 (1.0); 2.2233 (1.6); 2.2156 (0.9); 2.2009 (0.7); 2.1756 (0.5); 2.0728 (2.1); 2.0556 (0.5); 2.0503
(0.5); 2.0299 (0.8); 2.0041 (1.1); 1.9856 (1.9); 1.9806 (1.3); 1.9690 (1.6); 1.9504 (1.1); 1.9251 (0.6);
1.9091 (0.5); 1.8660 (0.6); 1.8452 (0.5); 1.8008 (0.5); 1.7831 (1.0); 1.7653 (1.0); 1.7444 (1.1); 1.2356
(0.6); 0.0079 (0.4); −0.0002 (9.5); −2.6466 (0.3)
I-593: ¹H-NMR(400.1 MHz, CDCl3):
δ = 8.3317 (10.0); 8.0869 (1.4); 8.0187 (2.3); 7.8923 (1.1); 7.8723 (1.1); 7.5807 (4.7); 7.5679 (6.8);
7.5397 (0.5); 7.5189 (0.7); 7.4766 (3.7); 7.4428 (0.5); 7.4324 (1.4); 7.4216 (2.0); 7.4170 (1.7); 7.4104
(1.3); 7.4038 (0.9); 7.3216 (0.6); 7.2590 (24.1); 7.2309 (0.3); 7.1925 (4.0); 7.1798 (4.2); 6.7883 (4.4);
6.7755 (4.1); 5.4852 (0.6); 5.4704 (1.4); 5.4519 (1.2); 5.4410 (0.6); 2.9566 (16.0); 2.8838 (15.0);
2.6752 (3.4); 2.6620 (2.0); 2.6184 (0.6); 2.3528 (0.4); 2.3403 (0.5); 2.3292 (1.4); 2.3164 (1.0); 2.3121
(1.0); 2.2909 (0.7); 2.2704 (0.6); 1.9141 (2.6); 1.9030 (4.3); 1.8990 (4.5); 1.8909 (3.2); 1.5892 (0.9);
1.4319 (3.4); −0.0002 (6.7)
I-594: ¹H-NMR(400.1 MHz, d₆-DMSO):
δ = 9.1476 (1.4); 9.1333 (2.7); 9.1182 (1.3); 8.1096 (0.5); 8.0712 (12.8); 7.9610 (2.4); 7.7626 (5.6);
7.5289 (0.9); 7.5249 (0.8); 7.5079 (5.6); 7.5037 (6.4); 7.4994 (8.7); 7.4783 (1.3); 7.2096 (0.9); 7.1890
(3.8); 7.1820 (2.3); 7.1727 (6.6); 7.1657 (2.4); 7.1608 (2.4); 7.1455 (0.7); 7.1404 (0.5); 6.9749 (1.2);
6.9657 (1.2); 6.9588 (2.0); 6.9522 (2.0); 6.9395 (1.2); 6.9344 (1.0); 6.0612 (0.9); 6.0499 (1.4); 6.0361
(0.9); 5.9459 (0.9); 5.9348 (1.4); 5.9207 (1.0); 3.9104 (0.8); 3.8957 (2.1); 3.8825 (1.6); 3.8724 (1.1);
3.8531 (1.0); 3.8381 (2.2); 3.8235 (1.8); 3.8136 (0.9); 3.3138 (168.1); 2.8991 (16.0); 2.7400 (14.2);
2.5136 (17.6); 2.5092 (23.9); 2.5049 (17.7); 2.1141 (0.5); 2.1013 (1.0); 2.0928 (1.1); 2.0803 (2.0);
2.0675 (1.2); 2.0592 (1.1); 2.0464 (0.5); 1.0550 (1.2); 1.0440 (3.6); 1.0386 (3.9); 1.0284 (2.1); 1.0230
(3.6); 1.0176 (3.8); 1.0075 (1.5); 0.8123 (1.5); 0.8018 (4.1); 0.7972 (4.4); 0.7892 (4.0); 0.7843 (4.3);
0.7731 (1.2)
I-595: ¹H-NMR(601.6 MHz, CD3CN):
δ = 9.2569 (16.0); 8.0574 (1.0); 7.7494 (2.2); 7.7362 (6.2); 7.7230 (4.9); 7.7011 (5.8); 7.6881 (3.1);
7.6072 (8.0); 7.6065 (8.2); 7.6037 (5.7); 7.5486 (3.6); 7.5476 (3.9); 7.5469 (3.8); 7.5459 (3.6); 7.5448
(3.5); 7.5352 (3.2); 7.5344 (3.3); 7.5334 (3.3); 7.5324 (3.1); 7.5315 (3.0); 7.5305 (2.9); 7.5179 (9.5);
7.5039 (10.7); 7.4895 (6.9); 7.4873 (7.8); 7.4861 (8.0); 7.4840 (7.2); 7.2600 (6.3); 7.2565 (6.2);
7.2460 (5.6); 7.2425 (5.6); 7.1221 (5.1); 7.0327 (11.2); 6.9435 (5.6); 6.0867 (2.1); 6.0802 (2.3);
6.0768 (2.4); 6.0703 (2.2); 6.0104 (2.1); 6.0040 (2.3); 6.0006 (2.4); 5.9941 (2.2); 4.0687 (1.2); 4.0623
(1.2); 4.0585 (1.2); 4.0521 (1.2); 4.0444 (2.3); 4.0379 (2.3); 4.0341 (2.3); 4.0310 (1.5); 4.0277 (2.4);
4.0246 (1.3); 4.0208 (1.4); 4.0143 (1.2); 4.0066 (2.4); 4.0002 (2.2); 3.9964 (4.5); 3.9899 (2.3); 3.9862
(3.7); 3.9760 (2.3); 3.9721 (1.4); 3.9618 (2.0); 3.9569 (2.3); 3.9516 (1.3); 3.9466 (3.7); 3.9364 (2.2);
3.9325 (1.4); 3.9222 (2.0); 3.9120 (1.2); 2.5362 (1.5); 2.2025 (335.7); 2.1155 (0.9); 2.1035 (0.4);
2.0949 (0.3); 2.0867 (0.6); 2.0826 (1.0); 2.0786 (1.3); 2.0745 (0.9); 2.0703 (0.5); 1.9923 (18.4);
1.9842 (5.2); 1.9800 (5.6); 1.9762 (70.3); 1.9721 (129.8); 1.9680 (177.6); 1.9638 (126.8); 1.9597
(65.8); 1.9551 (2.1); 1.9509 (1.1); 1.8614 (0.4); 1.8573 (0.8); 1.8532 (1.2); 1.8492 (0.8); 1.8450 (0.4);
1.6599 (0.6); 1.5004 (0.5); 1.4186 (0.8); 1.2993 (0.7)
I-596: ¹H-NMR(499.9 MHz, CDCl3):
δ = 7.5458 (2.6); 7.5367 (3.0); 7.5298 (3.0); 7.5158 (5.8); 7.4715 (0.4); 7.4281 (3.8); 7.3796 (2.0);
7.3661 (2.1); 7.2558 (2.1); 7.0468 (2.4); 7.0312 (3.0); 7.0120 (1.3); 6.9589 (4.6); 6.8645 (2.5); 6.8502
(2.1); 6.1944 (0.7); 6.0500 (1.0); 6.0399 (1.6); 5.2892 (0.4); 3.7628 (1.9); 3.7497 (4.4); 3.7371 (4.5);
3.7245 (2.0); 3.0628 (1.6); 3.0480 (4.1); 3.0331 (4.1); 3.0182 (1.6); 2.9471 (3.0); 2.9337 (5.4); 2.9206
(3.2); 2.2942 (15.4); 2.2877 (9.5); 2.2497 (16.0); 2.1681 (0.7); 1.5881 (0.8); 1.4000 (0.4); 1.3851
(0.6); 1.3579 (4.5); 1.3431 (8.3); 1.3282 (4.2); 1.2583 (0.5); 1.2520 (0.4); −0.0002 (2.0)
I-597: ¹H-NMR(300.2 MHz, CDCl3):
δ = 8.8980 (5.7); 7.8736 (0.4); 7.8547 (0.6); 7.8359 (0.4); 7.7172 (1.7); 7.7091 (1.3); 7.7005 (3.2);
7.6973 (3.3); 7.5608 (1.5); 7.5302 (2.0); 7.5011 (3.9); 7.4934 (1.5); 7.4866 (1.1); 7.4766 (0.8); 7.4680
(0.5); 7.4370 (3.4); 7.4089 (1.8); 7.2982 (7.6); 4.2956 (1.0); 4.2755 (0.9); 4.2477 (2.0); 4.2276 (1.9);
4.1998 (1.0); 4.1797 (1.0); 2.8443 (16.0); 1.5892 (5.8); 0.0369 (7.6)
I-598: ¹H-NMR(400.1 MHz, d₆-DMSO):
δ = 9.2758 (1.7); 9.2601 (3.6); 9.2444 (1.9); 8.0059 (16.0); 7.9616 (1.3); 7.7558 (5.8); 7.7514 (6.2);
7.5949 (5.5); 7.5735 (6.4); 7.2861 (3.4); 7.2814 (3.5); 7.2651 (3.1); 7.2602 (3.1); 7.2066 (1.6); 7.1870
(4.4); 7.1672 (3.7); 7.1409 (2.2); 7.1369 (2.6); 7.1196 (3.2); 7.1027 (1.5); 7.0990 (1.4); 6.9755 (1.8);
6.9720 (1.9); 6.9564 (3.2); 6.9394 (1.7); 4.3046 (1.7); 4.2889 (1.8); 4.2701 (3.8); 4.2544 (3.8); 4.2357
(2.1); 4.2197 (1.9); 3.3140 (192.8); 2.8994 (7.2); 2.7405 (6.5); 2.5137 (20.5); 2.5094 (28.1); 2.5051
(21.4); 2.1139 (0.6); 2.1009 (1.2); 2.0925 (1.4); 2.0799 (2.6); 2.0673 (1.7); 2.0590 (1.5); 2.0462 (0.8);
1.0576 (1.5); 1.0465 (4.6); 1.0412 (5.1); 1.0307 (2.8); 1.0254 (4.9); 1.0201 (5.1); 1.0099 (2.2); 0.8149
(1.9); 0.8041 (5.4); 0.7997 (5.8); 0.7917 (5.5); 0.7869 (6.0); 0.7754 (1.9)
I-599: ¹H-NMR(400.1 MHz, d₆-DMSO):
δ = 9.1950 (1.7); 9.1806 (3.2); 9.1688 (1.9); 8.8569 (6.9); 8.8514 (7.2); 8.7188 (3.7); 8.7123 (3.9);
8.7065 (4.3); 8.7025 (4.0); 8.7000 (4.0); 8.1989 (8.0); 8.1950 (7.7); 8.1920 (7.8); 8.0712 (0.7); 8.0642
(0.7); 7.9604 (4.0); 7.8050 (1.0); 7.7834 (3.1); 7.7485 (11.0); 7.7238 (5.9); 7.7193 (5.4); 7.7114 (4.6);
7.7068 (4.5); 7.6633 (4.0); 7.6448 (2.9); 7.5762 (4.7); 7.5556 (9.4); 7.5230 (9.3); 7.5061 (5.3); 4.1906
(1.5); 4.1759 (1.7); 4.1572 (3.3); 4.1428 (3.3); 4.1255 (2.1); 4.1098 (2.0); 3.3414 (145.0); 3.3374
(142.9); 3.3348 (144.3); 2.9019 (15.6); 2.8974 (15.6); 2.8959 (16.0); 2.7422 (14.7); 2.7378 (15.4);
2.7366 (15.5); 2.5099 (28.4); 1.2440 (0.4)
I-600: ¹H-NMR(400.1 MHz, d₆-DMSO):
δ = 9.2625 (1.4); 9.2423 (1.5); 8.1044 (6.2); 7.9607 (1.4); 7.3865 (1.1); 7.3663 (2.3); 7.3462 (1.3);
6.8820 (1.1); 6.8777 (1.4); 6.8568 (1.6); 6.8397 (7.6); 6.8167 (1.5); 5.1257 (0.8); 5.1075 (0.8); 5.0921
(0.4); 3.7671 (16.0); 3.3300 (15.4); 2.8982 (8.6); 2.7388 (8.0); 2.5457 (0.6); 2.5302 (1.6); 2.5134
(9.4); 2.5092 (11.6); 2.5050 (8.9); 2.0517 (0.5); 2.0392 (0.6); 2.0306 (0.6); 2.0178 (0.5); 1.9038 (0.4);
1.8917 (0.4); 1.8784 (0.6); 1.8571 (0.5); 1.8425 (0.5); 1.8227 (0.6); 1.8038 (0.6); 1.7910 (1.0);
1.7766 (1.2)
I-601: ¹H-NMR(300.2 MHz, CDCl3):
δ = 8.3411 (0.4); 8.3036 (8.0); 7.7790 (1.0); 7.6751 (0.5); 7.6579 (5.4); 7.6497 (2.4); 7.6370 (2.4);
7.6106 (0.6); 7.3808 (2.6); 7.3317 (1.1); 7.3246 (1.5); 7.3096 (1.4); 7.3022 (3.7); 7.2943 (0.8); 7.2123
(4.6); 7.1856 (5.6); 6.9322 (4.5); 6.9060 (3.7); 5.3366 (2.0); 3.6945 (5.9); 3.6771 (5.8); 2.3934 (0.3);
2.2062 (16.0); 1.6721 (1.2); 1.2995 (0.4); 0.9864 (0.3); 0.9543 (8.0); 0.9447 (8.0); 0.9119 (0.4);
0.1177 (0.5); 0.0426 (2.1)
I-602: ¹H-NMR(300.1 MHz, CDCl3):
δ = 9.1779 (0.8); 8.0086 (7.3); 7.9840 (0.4); 7.6066 (0.6); 7.5614 (3.5); 7.5184 (0.6); 7.4965 (5.5);
7.4737 (2.1); 7.4474 (0.6); 7.4088 (1.6); 7.3860 (2.6); 7.3311 (1.3); 7.3076 (2.3); 7.2799 (1.8); 7.2607
(102.6); 7.2168 (4.4); 7.1886 (3.4); 7.1634 (2.3); 7.0760 (2.2); 7.0510 (1.5); 6.9096 (0.5); 4.0866
(16.0); 3.9056 (2.4); 3.4898 (0.9); 3.1938 (1.9); 3.1722 (2.9); 3.1519 (1.7); 2.0078 (0.6); 1.6068 (8.6);
0.1955 (0.4); 0.0106 (4.4); −0.0001 (85.7); −0.0111 (3.0); −0.1988 (0.4)
I-603: ¹H-NMR(300.2 MHz, CDCl3):
δ = 8.4021 (9.1); 8.0709 (1.0); 7.9036 (2.9); 7.8916 (1.6); 7.8754 (4.3); 7.8599 (1.9); 7.8397 (4.4);
7.8101 (1.7); 7.6526 (0.3); 7.6261 (5.4); 7.6089 (4.5); 7.5802 (0.5); 7.5614 (0.8); 7.5578 (0.7); 7.5477
(4.6); 7.5385 (2.9); 7.5350 (2.8); 7.5243 (4.3); 7.5162 (8.6); 7.4893 (2.0); 7.4838 (1.8); 7.4527 (1.2);
7.4447 (1.3); 7.4339 (1.6); 7.4277 (1.4); 7.4223 (0.9); 7.4143 (0.7); 7.3040 (13.9); 4.9408 (5.6);
4.9216 (5.6); 1.6062 (16.0); 1.3276 (0.4); 1.2989 (1.5); 0.1149 (0.5); 0.0547 (0.5); 0.0440 (13.2);
0.0331 (0.6)
I-604: ¹H-NMR(300.2 MHz, CDCl3):
δ = 7.5222 (1.6); 7.5018 (4.7); 7.4990 (4.0); 7.4850 (0.4); 7.4814 (0.4); 7.4416 (2.2); 7.3985 (0.9);
7.3885 (1.5); 7.3810 (1.2); 7.3737 (2.5); 7.3601 (0.7); 7.3470 (2.4); 7.2987 (1.5); 7.0767 (2.4); 6.9897
(1.3); 6.9610 (1.5); 6.9367 (1.2); 6.9161 (0.6); 4.2415 (1.0); 4.2206 (0.9); 4.1923 (2.0); 4.1714 (2.0);
4.1431 (1.0); 4.1222 (1.0); 2.5559 (16.0); 2.5119 (6.9); 2.3596 (0.4); 2.3250 (9.2); 2.2189 (15.8);
1.7781 (1.3); 1.2966 (0.4); 0.0375 (1.3)
I-605: ¹H-NMR(300.2 MHz, CDCl3):
δ = 8.9255 (5.6); 7.8860 (0.4); 7.8685 (0.7); 7.8499 (0.4); 7.7239 (1.5); 7.7165 (1.2); 7.7119 (1.3);
7.7051 (3.6); 7.7024 (3.6); 7.6900 (0.4); 7.5903 (2.7); 7.5861 (2.5); 7.5767 (1.8); 7.5167 (0.7); 7.5060
(1.0); 7.4989 (1.0); 7.4863 (0.8); 7.4782 (0.5); 7.4316 (0.4); 7.4036 (2.8); 7.3951 (4.4); 7.3668 (0.4);
7.2988 (7.6); 6.1374 (0.5); 6.1267 (0.6); 6.1132 (0.6); 6.1024 (0.5); 5.9816 (0.5); 5.9709 (0.6); 5.9574
(0.6); 5.9467 (0.5); 4.3399 (0.3); 4.3293 (0.3); 4.3173 (0.3); 4.3066 (0.4); 4.2482 (0.3); 4.2255 (0.4);
4.2147 (0.3); 4.1924 (0.7); 4.1685 (2.2); 4.1447 (2.2); 4.1210 (0.8); 3.8885 (0.4); 3.8810 (0.4); 3.8641
(0.4); 3.8567 (0.3); 3.8366 (0.5); 3.8193 (0.4); 3.8148 (0.4); 3.7953 (0.3); 2.8442 (16.0); 2.0812
(10.0); 1.6028 (6.0); 1.3192 (2.6); 1.2954 (5.1); 1.2716 (2.5); 0.0358 (7.6)
I-606: ¹H-NMR(300.2 MHz, CDCl3):
δ = 8.2101 (5.0); 7.9827 (0.6); 7.9558 (0.6); 7.6176 (1.4); 7.5982 (3.8); 7.5949 (3.6); 7.5234 (1.7);
7.4740 (0.7); 7.4637 (1.1); 7.4565 (0.9); 7.4434 (0.7); 7.4362 (0.4); 7.2997 (18.2); 6.6290 (4.6);
5.4034 (0.6); 5.3791 (0.6); 2.7810 (16.0); 2.6205 (1.4); 2.6075 (1.3); 2.3103 (0.6); 2.2974 (0.5);
2.2838 (0.4); 2.2674 (0.4); 2.0843 (0.9); 1.9342 (1.3); 1.9244 (1.2); 1.9147 (2.6); 1.9031 (1.3); 1.8954
(1.3); 1.5851 (8.8); 1.2987 (0.5); 0.0501 (0.7); 0.0393 (19.1); 0.0283 (0.7)
I-607: ¹H-NMR(400.1 MHz, d₆-DMSO):
δ = 9.2742 (1.7); 9.2589 (3.6); 9.2433 (1.8); 8.0491 (0.6); 8.0056 (16.0); 7.9611 (1.6); 7.8688 (6.0);
7.8651 (6.4); 7.5149 (4.7); 7.4937 (7.0); 7.4142 (3.9); 7.4098 (3.9); 7.3931 (2.8); 7.3889 (2.8); 7.2093
(1.5); 7.1895 (4.3); 7.1696 (3.6); 7.1424 (2.2); 7.1383 (2.5); 7.1211 (3.2); 7.1041 (1.5); 7.1007 (1.3);
6.9772 (1.7); 6.9734 (1.8); 6.9579 (3.2); 6.9408 (1.7); 4.2992 (1.6); 4.2839 (1.8); 4.2650 (3.7); 4.2493
(3.6); 4.2306 (2.0); 4.2148 (1.9); 3.3147 (242.4); 2.8993 (9.2); 2.7404 (8.2); 2.5138 (22.7); 2.5094
(31.4); 2.5050 (23.7); 2.1169 (0.5); 2.1045 (1.2); 2.0963 (1.4); 2.0835 (2.5); 2.0709 (1.6); 2.0627
(1.5); 2.0499 (0.8); 1.0592 (1.5); 1.0482 (4.5); 1.0429 (5.0); 1.0325 (2.8); 1.0271 (4.8); 1.0218 (5.1);
1.0116 (2.1); 0.9955 (0.5); 0.8181 (1.9); 0.8075 (5.3); 0.8029 (5.7); 0.7950 (5.4); 0.7902 (5.8);
0.7788 (2.0)
I-608: ¹H-NMR(400.1 MHz, d₆-DMSO):
δ = 9.3503 (1.6); 9.3303 (1.7); 8.1314 (6.9); 7.9605 (2.4); 7.2505 (0.6); 7.2298 (1.6); 7.2267 (1.6);
7.2059 (1.2); 7.1720 (1.2); 7.1542 (1.6); 7.1354 (0.7); 6.9856 (0.9); 6.9823 (0.9); 6.9659 (1.6); 6.9486
(0.9); 6.8442 (5.9); 5.1522 (0.4); 5.1371 (0.9); 5.1192 (0.9); 5.1060 (0.4); 3.9017 (16.0); 3.3301
(17.0); 2.8981 (14.2); 2.7387 (13.1); 2.5520 (0.7); 2.5367 (1.7); 2.5131 (9.3); 2.5091 (12.3); 2.5053
(9.5); 2.0748 (0.5); 2.0554 (0.7); 2.0440 (0.6); 2.0357 (0.6); 1.9216 (0.4); 1.9069 (0.5); 1.8922 (0.7);
1.8694 (0.7); 1.8496 (0.8); 1.8325 (0.6); 1.8275 (0.6); 1.8169 (0.6); 1.8007 (1.0); 1.7783 (0.6); 1.7570
(0.5); 1.7415 (0.4)
I-609: ¹H-NMR(300.1 MHz, CDCl3):
δ = 8.2839 (16.0); 7.6294 (1.5); 7.6171 (8.8); 7.6138 (9.6); 7.6090 (4.4); 7.6040 (4.0); 7.5944 (4.6);
7.5681 (0.9); 7.3713 (3.9); 7.2691 (1.8); 7.2610 (13.7); 7.2484 (2.2); 7.2412 (2.3); 7.2315 (1.2);
7.2150 (0.3); 7.2024 (0.9); 7.1932 (6.7); 7.1647 (8.3); 6.9321 (7.5); 6.9036 (6.0); 6.6175 (3.6); 6.3717
(7.5); 6.1260 (3.8); 3.8312 (2.2); 3.8095 (5.0); 3.7898 (5.0); 3.7676 (2.4); 2.9671 (3.9); 2.9447 (7.1);
2.9224 (3.5); 0.0000 (2.4)
I-610: ¹H-NMR(300.2 MHz, CDCl3):
δ = 8.7542 (0.9); 8.7511 (1.2); 8.7490 (1.2); 8.7459 (1.0); 8.7381 (1.0); 8.7349 (1.2); 8.7328 (1.2);
8.7296 (1.0); 7.8912 (0.8); 7.8854 (0.8); 7.8654 (1.6); 7.8596 (1.6); 7.8395 (1.0); 7.8337 (0.9); 7.5691
(1.1); 7.5436 (3.4); 7.5372 (2.0); 7.5194 (2.5); 7.5138 (1.9); 7.4907 (2.0); 7.4874 (1.5); 7.4831 (1.2);
7.4754 (1.6); 7.4680 (1.7); 7.4648 (2.0); 7.4613 (1.4); 7.4510 (0.9); 7.4432 (0.7); 7.4384 (1.2); 7.4347
(1.1); 7.4220 (1.1); 7.4184 (1.1); 7.4128 (1.0); 7.4091 (0.9); 7.3964 (1.0); 7.3928 (0.9); 7.2989 (3.0);
7.2353 (1.6); 7.2086 (2.0); 7.0186 (1.9); 6.9439 (1.1); 6.9172 (0.9); 6.6959 (0.5); 6.6759 (0.9); 6.6560
(0.5); 3.9897 (0.9); 3.9691 (0.8); 3.9399 (1.9); 3.9193 (1.8); 3.8901 (1.0); 3.8695 (0.9); 2.5154 (16.0);
2.3953 (5.7); 2.3881 (3.2); 2.2920 (7.7); 2.0770 (0.5); 1.8400 (7.6); 1.3029 (0.8); 1.2928 (0.7); 0.9179
(0.9); 0.8947 (0.3); 0.0363 (2.2)
I-611: ¹H-NMR(300.1 MHz, CDCl3):
δ = 9.7840 (0.7); 8.3739 (1.6); 8.3598 (1.7); 7.9784 (8.7); 7.7873 (0.7); 7.7822 (0.7); 7.7614 (1.5);
7.7565 (1.5); 7.7359 (0.9); 7.7307 (0.9); 7.4589 (0.8); 7.4333 (2.9); 7.4261 (2.7); 7.3985 (2.5); 7.3901
(2.6); 7.3636 (2.1); 7.2796 (2.6); 7.2603 (9.6); 7.2539 (4.0); 7.2377 (1.2); 7.2198 (1.3); 7.2141 (1.2);
7.1961 (1.0); 7.1295 (1.9); 7.1036 (1.4); 6.9939 (1.4); 6.9682 (1.4); 6.9460 (2.5); 6.8102 (3.1); 3.8291
(1.2); 3.8136 (2.2); 3.7943 (2.1); 3.7882 (2.3); 3.7732 (1.5); 3.0046 (2.4); 2.9831 (3.0); 2.9628 (2.2);
2.2310 (16.0); 0.0102 (0.4); −0.0005 (9.2)
I-612: ¹H-NMR(400.1 MHz, CDCl3):
δ = 8.1394 (0.8); 8.0861 (5.5); 8.0156 (0.7); 7.5346 (3.0); 7.3549 (1.2); 7.3351 (2.8); 7.3236 (7.8);
7.3159 (2.3); 7.2599 (11.0); 7.0184 (1.6); 6.9988 (1.5); 6.9697 (1.2); 6.9659 (1.4); 6.9496 (1.0);
6.9457 (1.3); 6.9116 (1.9); 6.9073 (2.5); 6.0578 (0.6); 6.0495 (0.7); 6.0409 (0.7); 6.0327 (0.6); 5.9417
(0.6); 5.9333 (0.7); 5.9248 (0.7); 5.9165 (0.6); 4.2221 (0.4); 4.2137 (0.4); 4.2058 (0.4); 4.1971 (0.4);
4.1777 (0.3); 4.1574 (0.4); 4.1490 (0.4); 4.1411 (0.4); 4.1328 (0.4); 3.8585 (0.3); 3.8450 (0.4); 3.8420
(0.4); 3.8283 (0.4); 3.8044 (0.6); 3.7900 (0.6); 3.7727 (0.4); 3.7664 (0.4); 3.7529 (0.4); 3.7499 (0.4);
2.9537 (5.1); 2.8820 (4.6); 2.7071 (16.0); 1.9560 (0.6); 1.9475 (0.7); 1.9351 (1.2); 1.9227 (0.7);
1.9141 (0.7); 1.9013 (0.3); 1.5659 (12.5); 1.0220 (0.7); 1.0101 (2.1); 1.0055 (2.3); 0.9940 (1.2);
0.9891 (2.2); 0.9845 (2.1); 0.9733 (0.9); 0.7530 (0.8); 0.7412 (2.7); 0.7374 (2.4); 0.7290 (2.3); 0.7249
(2.8); 0.7127 (0.8); −0.0002 (2.3)
I-613: ¹H-NMR(400.1 MHz, d₆-DMSO):
δ = 9.1350 (1.0); 9.0646 (0.7); 8.7270 (1.1); 8.7133 (2.4); 8.6995 (1.5); 7.9596 (2.7); 7.7713 (8.8);
7.4692 (2.2); 7.4655 (2.3); 7.4507 (2.6); 7.4469 (2.7); 7.2158 (1.2); 7.2006 (4.4); 7.1952 (5.9); 7.1758
(4.8); 7.1560 (4.4); 7.1357 (3.3); 7.1177 (1.8); 7.1136 (2.0); 7.0975 (2.3); 7.0798 (1.1); 6.9478 (0.6);
6.9293 (1.6); 6.9145 (2.5); 6.8973 (1.4); 6.8790 (0.4); 6.8632 (0.4); 6.7357 (0.5); 6.7278 (0.5); 6.7174
(0.4); 6.7080 (0.4); 3.9336 (0.6); 3.7005 (1.2); 3.6836 (3.3); 3.6678 (3.5); 3.6508 (1.6); 3.4526 (0.4);
3.4336 (0.4); 3.3398 (152.3); 3.1817 (2.6); 3.1640 (5.0); 3.1464 (2.5); 3.0761 (1.8); 2.8971 (16.0);
2.7380 (14.8); 2.7102 (0.5); 2.6819 (0.4); 2.6349 (0.4); 2.6286 (0.7); 2.5903 (24.8); 2.5804 (6.0);
2.5695 (25.3); 2.5132 (13.0); 2.5091 (17.3); 2.5050 (13.3); 2.4622 (0.5); 2.4408 (0.4); 2.0897 (0.5);
2.0770 (1.0); 2.0690 (1.3); 2.0564 (2.1); 2.0385 (3.8); 2.0231 (0.8); 1.2115 (3.4); 1.1948 (3.3); 1.1687
(0.8); 1.1518 (0.6); 1.0472 (1.2); 1.0361 (3.4); 1.0308 (4.0); 1.0205 (3.0); 1.0152 (4.2); 1.0099 (4.2);
1.0000 (2.3); 0.8011 (1.3); 0.7863 (4.8); 0.7735 (5.3); 0.7621 (2.2)
I-614: ¹H-NMR(400.2 MHz, d₆-DMSO):
δ = 8.9844 (1.3); 8.9630 (1.4); 8.3105 (9.1); 7.8195 (0.6); 7.8062 (6.2); 7.7158 (0.6); 7.6963 (1.6);
7.6763 (1.4); 7.6352 (1.9); 7.6198 (3.2); 7.5798 (1.4); 7.5575 (1.1); 7.2449 (1.8); 7.2251 (2.0); 6.9705
(2.7); 6.9607 (1.7); 6.9404 (1.2); 5.8064 (0.6); 5.7878 (1.1); 5.7696 (0.6); 5.1621 (0.7); 5.1412 (0.7);
5.1253 (0.4); 4.6143 (1.0); 4.5956 (1.8); 4.5771 (1.0); 3.9320 (1.6); 3.9113 (1.3); 3.9041 (2.0); 3.4649
(0.4); 3.4312 (1.4); 3.4032 (1.8); 3.3954 (2.1); 3.3823 (1.9); 3.3665 (3.0); 3.3280 (1644.3); 3.2542
(0.4); 2.7435 (0.8); 2.7279 (1.5); 2.7129 (1.5); 2.6951 (0.9); 2.6808 (3.4); 2.6763 (6.6); 2.6717 (9.2);
2.6672 (6.9); 2.6628 (3.4); 2.6300 (0.6); 2.6024 (16.0); 2.5774 (0.9); 2.5420 (5.2); 2.5251 (26.6);
2.5204 (41.7); 2.5117 (519.9); 2.5073 (1040.2); 2.5027 (1366.1); 2.4981 (992.1); 2.4936 (483.4);
2.3855 (0.4); 2.3386 (2.8); 2.3341 (6.0); 2.3296 (8.3); 2.3251 (6.2); 2.3206 (2.9); 2.0726 (1.3); 2.0111
(0.4); 1.9975 (0.5); 1.9782 (0.7); 1.9540 (0.4); 1.8644 (0.6); 1.8463 (0.5); 1.7918 (0.4); 1.7640 (0.9);
1.7486 (1.3); 1.7239 (0.9); 1.7056 (0.5); 1.6205 (1.9); 1.6098 (3.3); 1.6018 (3.0); 1.2369
(0.4); −0.0002 (4.1)
I-615: ¹H-NMR(400.1 MHz, CDCl3):
δ = 8.2791 (9.2); 7.9294 (1.1); 7.6520 (0.3); 7.6317 (4.6); 7.6188 (5.5); 7.4741 (3.1); 7.4546 (0.4);
7.4446 (1.2); 7.4382 (1.2); 7.4332 (1.7); 7.4284 (1.5); 7.4221 (1.1); 7.4159 (0.8); 7.3317 (2.0); 7.3121
(2.3); 7.2588 (7.9); 7.2249 (1.8); 7.2063 (2.2); 7.0643 (1.5); 7.0450 (2.3); 7.0258 (1.0); 5.2968 (0.4);
4.2878 (1.5); 4.2731 (1.5); 4.2516 (3.1); 4.2368 (3.0); 4.2153 (1.6); 4.2005 (1.5); 2.3986 (10.6);
2.3357 (0.4); 2.2983 (16.0); 1.5505 (3.5); 1.4318 (0.6); −0.0002 (5.1)
I-616: ¹H-NMR(300.2 MHz, CDCl3):
δ = 8.3064 (16.0); 8.0379 (1.1); 8.0177 (1.8); 8.0002 (1.1); 7.6692 (1.6); 7.6431 (4.3); 7.6167 (3.2);
7.5568 (3.9); 7.5233 (6.1); 7.4940 (10.8); 7.4387 (10.2); 7.4164 (6.2); 7.4114 (6.6); 7.3810 (2.8);
7.3542 (2.3); 7.3051 (19.8); 6.9391 (2.9); 6.7516 (5.8); 6.5642 (2.9); 4.2749 (2.7); 4.2547 (2.7);
4.2274 (5.8); 4.2072 (5.6); 4.1798 (3.1); 4.1597 (2.8); 2.0893 (2.5); 1.6006 (8.8); 1.3271 (0.8); 1.3032
(2.0); 1.2795 (0.8); 0.0544 (0.6); 0.0437 (19.3); 0.0329 (0.8)
I-617: ¹H-NMR(400.1 MHz, CDCl3):
δ = 8.3208 (9.4); 8.0174 (1.9); 7.8615 (1.0); 7.8432 (1.0); 7.6057 (0.3); 7.5848 (3.1); 7.5792 (2.5);
7.5724 (6.0); 7.5707 (6.1); 7.4900 (3.2); 7.4719 (0.4); 7.4614 (1.3); 7.4516 (1.7); 7.4466 (1.6); 7.4390
(1.2); 7.4326 (0.8); 7.2594 (13.3); 6.4313 (4.3); 5.3783 (1.0); 5.3606 (1.1); 2.9559 (14.0); 2.8832
(12.8); 2.6174 (0.6); 2.5753 (2.3); 2.5666 (2.2); 2.3925 (16.0); 2.3102 (0.4); 2.2949 (0.5); 2.2817
(1.0); 2.2713 (1.0); 2.2628 (0.8); 2.2497 (0.7); 1.8981 (0.9); 1.8905 (0.9); 1.8823 (1.4); 1.8745 (2.3);
1.8615 (3.8); 1.8493 (2.2); 1.8386 (1.0); 1.8327 (0.7); 1.6637 (0.3); 1.4318 (1.8); −0.0002 (3.8)
I-618: ¹H-NMR(300.2 MHz, CDCl3):
δ = 8.2630 (5.2); 8.0506 (0.7); 7.6664 (1.9); 7.4898 (1.3); 7.4617 (3.1); 7.4557 (1.4); 7.4279 (3.8);
7.4006 (2.0); 7.2988 (20.8); 6.9523 (1.1); 6.9468 (1.2); 6.9236 (0.9); 6.9192 (1.0); 6.8214 (1.0);
6.8165 (1.2); 6.7871 (2.8); 6.7791 (2.3); 6.7719 (1.0); 5.3381 (1.0); 4.4814 (1.0); 4.4607 (1.0); 4.4336
(2.0); 4.4132 (2.0); 4.3859 (1.0); 4.3654 (1.0); 3.8783 (16.0); 1.5829 (13.8); 0.0384 (20.8); 0.0275 (1.2)
I-619: ¹H-NMR(400.1 MHz, d₆-DMSO):
δ = 9.1910 (2.2); 9.1767 (4.4); 9.1621 (2.5); 8.1160 (16.0); 7.9606 (2.6); 7.7601 (9.2); 7.6298 (6.3);
7.6093 (5.0); 7.5368 (2.2); 7.5144 (8.0); 7.5005 (11.7); 7.4760 (6.6); 7.4549 (2.6); 7.4346 (3.3);
7.3524 (0.5); 7.3344 (0.7); 7.2996 (6.5); 7.1646 (3.2); 6.0634 (1.4); 6.0518 (2.4); 6.0390 (1.6); 5.9486
(1.4); 5.9360 (2.3); 5.9236 (1.7); 3.9544 (0.3); 3.9400 (0.6); 3.9203 (1.2); 3.9032 (2.6); 3.8864 (3.1);
3.8737 (1.7); 3.8620 (1.9); 3.8468 (2.7); 3.8397 (2.2); 3.8293 (2.6); 3.8152 (1.5); 3.7898 (0.6); 3.7805
(0.4); 3.5862 (0.5); 3.5709 (0.6); 3.3257 (221.2); 2.9802 (0.4); 2.9639 (0.8); 2.9460 (0.4); 2.8989
(13.1); 2.7396 (12.4); 2.5099 (30.7); 1.2428 (0.4)
I-620: ¹H-NMR(400.1 MHz, CDCl3):
δ = 8.1144 (0.5); 8.1007 (0.8); 8.0872 (0.5); 8.0467 (5.4); 8.0158 (0.7); 7.4959 (2.2); 7.4746 (2.6);
7.4615 (2.4); 7.4592 (2.5); 7.3485 (1.2); 7.3287 (2.6); 7.3090 (1.5); 7.2599 (10.4); 7.2032 (1.4);
7.1986 (1.4); 7.1821 (1.2); 7.1775 (1.2); 7.0159 (1.6); 6.9964 (1.5); 6.9483 (1.2); 6.9442 (1.4); 6.9280
(1.0); 6.9241 (1.3); 6.8921 (1.9); 6.8878 (2.5); 4.4270 (1.0); 4.4116 (1.0); 4.3915 (2.2); 4.3761 (2.1);
4.3560 (1.1); 4.3406 (1.1); 2.9536 (4.8); 2.8820 (4.4); 2.6994 (16.0); 1.9520 (0.6); 1.9435 (0.7);
1.9310 (1.2); 1.9187 (0.7); 1.9102 (0.7); 1.8975 (0.3); 1.5639 (14.2); 1.0247 (0.7); 1.0128 (2.1);
1.0082 (2.2); 0.9967 (1.2); 0.9918 (2.2); 0.9873 (2.0); 0.9760 (0.8); 0.7506 (0.8); 0.7388 (2.7); 0.7350
(2.4); 0.7265 (2.3); 0.7224 (2.7); 0.7102 (0.7); −0.0002 (2.2)
I-621: ¹H-NMR(400.2 MHz, d₆-DMSO):
δ = 18.0412 (0.4); 12.9947 (0.4); 9.0609 (0.4); 9.0373 (1.2); 9.0148 (1.2); 8.9328 (0.4); 8.3118 (12.8);
7.8228 (5.3); 7.8004 (1.3); 7.7185 (0.6); 7.6981 (1.6); 7.6784 (1.4); 7.6380 (2.0); 7.6201 (3.6); 7.5984
(0.4); 7.5786 (1.4); 7.5556 (1.1); 7.5054 (0.4); 7.4913 (0.5); 7.3341 (2.3); 7.2652 (0.4); 7.2467 (6.0);
7.2219 (0.4); 7.2053 (0.4); 7.1791 (0.6); 7.1584 (0.6); 6.8050 (0.6); 6.7594 (0.4); 6.7347 (0.4); 5.8070
(0.5); 5.7873 (0.9); 5.7699 (0.5); 5.1415 (0.8); 5.1304 (0.8); 4.6139 (0.7); 4.5953 (1.4); 4.5770 (0.7);
3.7732 (0.4); 3.7295 (0.3); 3.7272 (0.4); 3.6934 (0.4); 3.6535 (0.4); 3.6170 (0.4); 3.5981 (0.4); 3.5741
(0.4); 3.5552 (0.5); 3.5369 (0.4); 3.5328 (0.5); 3.5072 (0.6); 3.4485 (0.9); 3.4375 (1.0); 3.3278
(2945.9); 3.2506 (0.4); 2.8560 (0.4); 2.7548 (1.4); 2.7388 (1.5); 2.6804 (5.9); 2.6761 (11.7); 2.6715
(16.0); 2.6670 (11.7); 2.6625 (7.2); 2.6071 (14.1); 2.6011 (5.0); 2.5418 (9.0); 2.5249 (59.1); 2.5201
(92.8); 2.5116 (978.3); 2.5071 (1927.0); 2.5026 (2503.5); 2.4980 (1809.5); 2.4935 (874.0); 2.4078
(0.8); 2.3720 (0.4); 2.3460 (0.8); 2.3385 (5.2); 2.3339 (11.0); 2.3294 (15.2); 2.3249 (11.1); 2.3205
(5.1); 2.2783 (0.4); 2.0729 (2.0); 2.0211 (0.4); 1.9947 (0.6); 1.9819 (0.8); 1.9753 (0.8); 1.8874 (0.5);
1.8572 (0.6); 1.8423 (0.7); 1.7968 (0.5); 1.7723 (0.9); 1.7555 (1.2); 1.7330 (1.0); 1.7083 (0.4); 1.2363
(0.6); 1.0450 (0.5); 0.8919 (0.6); 0.8706 (0.8); 0.8336 (0.4); 0.5697 (0.5); 0.5536 (0.4); −0.0002
(8.0); −3.0487 (0.3); −3.4068 (0.4); −3.4863 (0.4)
I-622: ¹H-NMR(400.1 MHz, CDCl3):
δ = 8.2769 (4.2); 7.8853 (0.6); 7.6237 (2.6); 7.6109 (2.4); 7.4594 (1.5); 7.4063 (0.6); 7.4001 (0.7);
7.3935 (0.8); 7.3886 (0.7); 7.3840 (0.5); 7.3776 (0.4); 7.2645 (1.9); 7.2589 (3.0); 7.2363 (0.8); 7.2167
(1.0); 7.1271 (1.4); 7.1077 (1.0); 5.2961 (0.8); 4.2114 (0.8); 4.1967 (0.7); 4.1760 (1.6); 4.1613 (1.5);
4.1405 (0.8); 4.1258 (0.8); 2.2300 (16.0); 1.5560 (2.1); −0.0002 (1.6)
I-623: ¹H-NMR(400.1 MHz, d₆-DMSO):
δ = 9.2976 (1.2); 9.2821 (2.7); 9.2667 (1.5); 8.8576 (6.8); 8.7218 (3.5); 8.7096 (3.6); 8.1505 (7.2);
8.0325 (0.7); 7.9605 (3.2); 7.7307 (3.6); 7.7185 (3.5); 7.5203 (0.6); 7.4993 (1.4); 7.4776 (1.6); 7.4561
(0.9); 7.4112 (0.6); 7.3908 (1.5); 7.3758 (1.7); 7.3469 (4.3); 7.3275 (5.2); 7.3078 (1.0); 7.0855 (4.7);
6.9601 (2.5); 6.9403 (2.4); 4.1689 (1.1); 4.1534 (1.2); 4.1325 (2.5); 4.1169 (2.4); 4.0962 (1.4); 4.0805
(1.4); 3.3234 (132.3); 2.8985 (14.7); 2.7395 (14.3); 2.5103 (17.0); 2.5084 (16.9); 2.4423 (11.3);
2.2832 (0.4); 2.2174 (16.0); 2.1823 (0.5)
I-624: ¹H-NMR(300.1 MHz, CDCl3):
δ = 8.2931 (10.0); 7.6415 (1.0); 7.6265 (1.0); 7.6089 (4.6); 7.6058 (5.8); 7.5851 (2.5); 7.5589 (0.6);
7.3482 (2.7); 7.2812 (1.1); 7.2744 (1.5); 7.2587 (7.7); 7.2524 (1.8); 7.2430 (0.7); 6.9848 (2.5); 6.9601
(2.9); 6.6948 (5.9); 6.6684 (1.6); 4.3049 (0.3); 3.8812 (1.4); 3.8593 (3.4); 3.8399 (3.3); 3.8178 (1.6);
3.1433 (2.6); 3.1208 (4.8); 3.0985 (2.3); 2.1490 (16.0); 1.9551 (0.3); 1.9369 (0.8); 1.9270 (0.8);
1.9192 (0.5); 1.9091 (1.5); 1.8987 (0.5); 1.8912 (0.9); 1.8811 (0.8); 1.8633 (0.4); 1.5810 (2.7); 0.9608
(0.6); 0.9475 (1.2); 0.9329 (2.9); 0.9267 (3.0); 0.9198 (1.8); 0.9126 (1.7); 0.9046 (3.1); 0.8983 (3.0);
0.8847 (1.4); 0.6423 (1.3); 0.6281 (3.0); 0.6226 (3.6); 0.6101 (3.1); 0.6045 (3.3); 0.5894
(1.0); −0.0005 (6.3)
I-625: ¹H-NMR(400.1 MHz, CDCl3):
δ = 8.1607 (0.9); 8.0802 (5.5); 8.0159 (0.5); 7.3390 (1.3); 7.3276 (2.2); 7.3193 (2.8); 7.3076 (2.4);
7.2996 (1.7); 7.2591 (9.3); 7.0227 (2.6); 7.0108 (1.8); 6.9910 (1.5); 6.9736 (1.2); 6.9691 (1.4); 6.9534
(1.0); 6.9489 (1.3); 6.9325 (1.4); 6.9117 (1.4); 6.9050 (2.2); 6.9003 (2.6); 4.2363 (1.0); 4.2215 (1.0);
4.2002 (2.2); 4.1853 (2.2); 4.1642 (1.1); 4.1493 (1.1); 2.9532 (3.6); 2.8819 (3.3); 2.7000 (16.0);
2.4730 (7.0); 2.2839 (9.9); 1.9475 (0.6); 1.9390 (0.7); 1.9266 (1.2); 1.9142 (0.7); 1.9056 (0.7); 1.8929
(0.3); 1.5647 (12.6); 1.0170 (0.7); 1.0053 (2.1); 1.0005 (2.2); 0.9890 (1.1); 0.9842 (2.2); 0.9796 (2.1);
0.9684 (0.8); 0.7469 (0.8); 0.7351 (2.7); 0.7313 (2.4); 0.7229 (2.3); 0.7188 (2.8); 0.7066
(0.7); −0.0002 (2.0)
I-626: ¹H-NMR(400.1 MHz, d₆-DMSO):
δ = 9.2518 (1.6); 9.2305 (1.7); 8.2194 (6.9); 7.9606 (2.0); 7.4938 (2.8); 7.3621 (1.4); 7.3575 (1.4);
7.3417 (1.7); 7.3369 (1.6); 7.2456 (0.6); 7.2244 (1.6); 7.2215 (1.5); 7.2035 (1.2); 7.2007 (1.3); 7.1694
(1.2); 7.1515 (1.6); 7.1329 (0.7); 7.1071 (2.4); 7.0866 (2.1); 6.9932 (0.9); 6.9898 (0.9); 6.9735 (1.6);
6.9563 (0.9); 5.1987 (0.3); 5.1794 (0.9); 5.1638 (0.9); 3.8997 (16.0); 3.3299 (18.4); 2.8981 (12.1);
2.7387 (11.8); 2.7234 (2.1); 2.7172 (2.0); 2.5131 (9.6); 2.5091 (12.6); 2.5050 (9.6); 2.0585 (0.4);
2.0333 (0.7); 2.0184 (0.6); 2.0013 (0.6); 1.9162 (0.4); 1.8900 (0.8); 1.8741 (0.5); 1.8578 (0.3); 1.7936
(1.4); 1.7769 (1.5); 1.7526 (0.9)
I-627: ¹H-NMR(400.1 MHz, CDCl3):
δ = 8.2782 (11.7); 8.0189 (2.3); 7.6270 (6.0); 7.6141 (6.4); 7.4771 (3.6); 7.4521 (0.4); 7.4422 (1.4);
7.4362 (1.4); 7.4300 (2.1); 7.4254 (1.8); 7.4197 (1.3); 7.4135 (0.9); 7.2588 (36.8); 6.7863 (4.0);
6.7152 (2.0); 6.6827 (2.0); 4.3403 (1.2); 4.3372 (1.2); 4.3251 (1.2); 4.3220 (1.2); 4.3046 (2.4); 4.3014
(2.4); 4.2893 (2.4); 4.2861 (2.3); 4.2655 (1.2); 4.2532 (1.2); 4.2503 (1.2); 2.9554 (7.9); 2.8835 (7.1);
2.4493 (5.2); 2.4390 (10.3); 2.4287 (5.4); 2.3070 (0.5); 2.2649 (16.0); 1.5519 (3.4); 1.4318 (3.1);
0.0079 (0.4); −0.0002 (10.4)
I-628: ¹H-NMR(400.0 MHz, d₆-DMSO):
δ = 8.9831 (1.5); 8.9700 (1.5); 7.9548 (0.3); 7.8068 (6.5); 7.7291 (0.5); 7.7091 (1.6); 7.6893 (2.7);
7.6685 (1.8); 7.6528 (1.8); 7.6342 (3.5); 7.6027 (1.6); 7.5820 (2.1); 7.5585 (1.1); 7.4235 (1.0); 7.4043
(1.6); 7.3852 (0.7); 7.3186 (1.7); 7.2989 (1.5); 3.3310 (24.1); 3.3119 (0.9); 3.3062 (0.8); 3.3022 (0.8);
3.2926 (0.7); 2.8915 (2.2); 2.7330 (1.9); 2.6120 (16.0); 2.5263 (0.4); 2.5127 (9.1); 2.5084 (18.8);
2.5039 (24.8); 2.4993 (17.6); 2.4949 (8.3); 2.3216 (0.4); 2.2997 (0.7); 1.4188 (1.2); 1.4126 (1.1);
1.3996 (2.3); 1.3889 (1.2); 1.3840 (1.1); 1.3759 (1.2); 1.2398 (0.5); −0.0002 (4.2)
I-629: ¹H-NMR(300.2 MHz, CDCl3):
δ = 8.2965 (2.3); 7.5863 (0.8); 7.5825 (0.8); 7.4592 (0.4); 7.4316 (0.8); 7.4046 (0.5); 7.3732 (2.1);
7.3699 (2.1); 7.2987 (15.1); 6.9540 (0.3); 6.9483 (0.4); 6.8373 (0.3); 6.8325 (0.4); 6.8299 (0.4);
6.8060 (0.5); 6.8031 (0.4); 6.7978 (0.6); 6.7903 (0.8); 6.7828 (0.3); 5.3380 (2.1); 3.8786 (6.3); 2.0835
(0.7); 1.5804 (16.0); 1.2978 (0.4); 0.0491 (0.5); 0.0383 (14.4); 0.0306 (0.4); 0.0275 (0.5)
I-630: ¹H-NMR(400.1 MHz, d₆-DMSO):
δ = 9.3183 (1.0); 9.3027 (2.2); 9.2866 (1.1); 8.0543 (9.3); 7.9605 (2.6); 7.9441 (0.5); 7.8648 (3.9);
7.8022 (0.9); 7.6427 (1.0); 7.6256 (1.9); 7.6095 (2.3); 7.5884 (2.0); 7.5694 (1.3); 7.5203 (2.6); 7.4989
(5.4); 7.4760 (2.6); 7.4562 (1.2); 7.4373 (4.0); 7.4160 (1.7); 7.4118 (1.7); 7.3026 (3.3); 7.2885 (0.5);
7.1676 (1.6); 4.3057 (0.9); 4.2902 (1.1); 4.2716 (2.2); 4.2558 (2.3); 4.2374 (1.4); 4.2214 (1.2); 3.3245
(151.7); 2.8987 (16.0); 2.7395 (14.5); 2.5137 (11.8); 2.5094 (16.3); 2.5052 (12.7)
I-631: ¹H-NMR(300.1 MHz, CDCl3):
δ = 8.2775 (9.6); 7.6204 (0.4); 7.6067 (4.6); 7.6036 (5.6); 7.5943 (2.3); 7.5834 (3.0); 7.5573 (1.2);
7.3562 (2.7); 7.3033 (1.1); 7.2964 (1.4); 7.2817 (1.4); 7.2745 (1.6); 7.2603 (7.8); 7.1405 (3.1); 7.0826
(2.6); 7.0566 (3.5); 6.9199 (1.8); 6.9161 (1.8); 6.8940 (1.4); 6.8901 (1.3); 3.8851 (1.4); 3.8659 (3.2);
3.8428 (3.0); 3.8240 (1.6); 3.1331 (9.8); 3.1082 (3.8); 3.0877 (2.4); 2.1523 (16.0); 1.5926 (0.5);
1.2535 (0.4); 0.0102 (0.3); −0.0005 (7.7)
I-632: ¹H-NMR(400.1 MHz, CDCl3):
δ = 8.0827 (5.3); 8.0369 (0.9); 8.0165 (1.6); 7.5381 (3.0); 7.3761 (0.7); 7.3552 (4.2); 7.3488 (3.0);
7.3451 (2.7); 7.3277 (0.5); 7.3240 (0.5); 7.2605 (11.5); 7.1379 (0.4); 7.1243 (2.6); 7.1177 (2.2);
7.1060 (3.6); 6.8585 (0.7); 6.8516 (0.7); 6.8422 (1.2); 6.8336 (1.0); 6.8183 (0.6); 6.0743 (0.6); 6.0661
(0.6); 6.0582 (0.6); 6.0499 (0.6); 5.9585 (0.6); 5.9503 (0.6); 5.9424 (0.6); 5.9340 (0.6); 4.2270 (0.4);
4.2187 (0.4); 4.2109 (0.4); 4.2020 (0.6); 4.1647 (0.4); 4.1563 (0.4); 4.1486 (0.4); 4.1403 (0.3); 3.9170
(0.3); 3.9016 (0.5); 3.8872 (0.4); 3.8649 (0.4); 3.8593 (0.4); 3.8506 (0.3); 3.8450 (0.5); 3.8292 (0.4);
3.8227 (0.3); 3.8083 (0.4); 2.9540 (9.4); 2.8821 (8.6); 2.7091 (16.0); 2.1292 (0.6); 2.1209 (0.6);
2.1080 (1.1); 2.0953 (0.7); 2.0870 (0.6); 1.5722 (12.5); 1.0526 (0.7); 1.0409 (2.0); 1.0363 (2.1);
1.0251 (1.1); 1.0197 (2.1); 1.0151 (2.0); 1.0041 (0.8); 0.8022 (0.8); 0.7905 (2.5); 0.7871 (2.4); 0.7780
(2.2); 0.7741 (2.5); 0.7619 (0.7); −0.0002 (2.5)
I-633: ¹H-NMR(400.0 MHz, d₆-DMSO):
δ = 9.4382 (2.3); 9.4230 (4.1); 9.4076 (1.9); 8.1765 (1.8); 8.1679 (16.0); 8.0474 (6.4); 8.0432 (6.4);
7.8772 (0.4); 7.8547 (0.5); 7.8188 (0.3); 7.7761 (3.0); 7.7715 (2.9); 7.7540 (3.9); 7.7502 (3.8); 7.7383
(1.9); 7.7176 (4.9); 7.6984 (11.1); 7.6761 (6.1); 7.6566 (2.8); 7.6385 (4.6); 7.6239 (6.5); 7.6039 (3.5);
4.2741 (2.0); 4.2492 (4.6); 4.2329 (4.4); 4.2240 (2.8); 4.2079 (2.1); 3.3397 (320.9); 3.3357 (269.2);
3.3326 (262.3); 2.7123 (0.5); 2.6717 (1.3); 2.5425 (123.6); 2.5073 (191.6); 2.5032 (245.2); 2.4990
(182.5); 2.3746 (0.5); 2.3692 (0.7); 2.3304 (1.4); 1.2595 (0.4); −0.0002 (6.0)
I-634: ¹H-NMR(400.0 MHz, d₆-DMSO):
δ = 8.6762 (2.9); 7.7245 (0.6); 7.7049 (1.8); 7.6850 (1.5); 7.6550 (7.2); 7.6384 (1.0); 7.5387 (2.4);
7.4981 (1.3); 7.4781 (1.1); 7.2670 (3.6); 7.2462 (4.7); 7.1128 (5.1); 7.0919 (4.0); 3.3258 (20.9);
2.9047 (6.3); 2.8924 (0.9); 2.7332 (0.5); 2.5694 (16.0); 2.5075 (18.6); 2.5030 (24.5); 2.4986 (17.8);
1.2402 (0.5); 0.8869 (1.0); 0.8692 (3.4); 0.8578 (1.5); 0.7578 (1.4); 0.7463 (3.2); 0.7429 (3.2); 0.7292
(0.9); −0.0002 (4.0)
I-635: ¹H-NMR(400.0 MHz, d₆-DMSO):
δ = 8.8172 (0.8); 8.8031 (1.7); 8.7887 (0.8); 8.7140 (16.0); 8.0877 (8.6); 7.7425 (0.7); 7.7229 (2.2);
7.7032 (2.3); 7.6894 (2.7); 7.6697 (1.0); 7.6321 (3.1); 7.5536 (1.7); 7.5341 (1.4); 3.8026 (1.2); 3.7862
(3.2); 3.7708 (3.3); 3.7546 (1.3); 3.3452 (28.9); 3.3431 (27.8); 3.1879 (2.4); 3.1712 (5.0); 3.1543
(2.2); 2.8933 (1.3); 2.7340 (1.2); 2.5146 (6.0); 2.5106 (12.6); 2.5062 (16.9); 2.5017 (12.4); 2.4975
(6.2); 1.2388 (0.5); −0.0002 (1.7)
I-636: ¹H-NMR(300.2 MHz, CDCl3):
δ = 7.9165 (0.4); 7.8969 (0.8); 7.8774 (0.4); 7.5524 (0.4); 7.5274 (1.2); 7.5023 (2.6); 7.4965 (2.2);
7.4915 (1.6); 7.4621 (1.9); 7.4595 (1.8); 7.4402 (2.6); 7.4279 (0.8); 7.4129 (2.4); 7.2986 (3.3); 7.0883
(2.0); 7.0431 (1.1); 7.0164 (0.9); 4.2751 (0.8); 4.2549 (0.8); 4.2249 (1.8); 4.2047 (1.8); 4.1746 (0.9);
4.1545 (0.9); 3.8427 (1.5); 3.8233 (3.1); 3.8039 (1.7); 3.3951 (0.6); 3.3837 (16.0); 3.1578 (1.6);
3.1384 (2.8); 3.1190 (1.4); 2.5442 (5.8); 2.5374 (3.5); 2.3196 (7.7); 2.1111 (0.5); 2.1002 (0.6); 2.0953
(0.4); 2.0841 (1.1); 2.0730 (0.4); 2.0679 (0.6); 2.0570 (0.6); 1.6344 (3.0); 1.3465 (0.6); 1.3323 (1.8);
1.3237 (2.1); 1.3165 (1.9); 1.3077 (2.0); 1.2954 (1.2); 1.2684 (3.6); 1.2560 (0.6); 1.1083 (0.7); 1.0961
(1.8); 1.0871 (1.6); 1.0815 (1.1); 1.0691 (1.8); 1.0601 (1.6); 1.0463 (0.6); 0.1098 (8.4); 0.0977 (0.3);
0.0376 (2.7)
I-637: ¹H-NMR(400.1 MHz, d₆-DMSO):
δ = 9.1906 (1.9); 9.1762 (3.9); 9.1614 (2.1); 8.1165 (12.5); 7.9605 (3.3); 7.6453 (8.9); 7.6293 (5.4);
7.6093 (4.0); 7.5787 (4.9); 7.5577 (6.1); 7.4927 (3.0); 7.4728 (4.4); 7.4528 (2.0); 7.4324 (2.6); 7.4055
(4.3); 7.3846 (3.5); 7.2974 (5.3); 7.1624 (2.6); 6.0786 (1.2); 6.0664 (2.0); 6.0545 (1.3); 5.9637 (1.1);
5.9509 (1.9); 5.9387 (1.3); 3.9442 (0.5); 3.9234 (1.0); 3.9073 (2.1); 3.8901 (2.6); 3.8758 (1.4); 3.8668
(1.5); 3.8519 (2.3); 3.8337 (2.0); 3.8187 (1.2); 3.8073 (0.5); 3.7931 (0.5); 3.3231 (174.1); 2.8988
(16.0); 2.7397 (15.5); 2.5104 (22.4); 1.2461 (0.4)
I-638: ¹H-NMR(400.1 MHz, CDCl3):
δ = 8.0377 (5.4); 8.0158 (1.0); 7.9923 (0.6); 7.9781 (0.9); 7.9647 (0.5); 7.5323 (2.3); 7.5111 (2.6);
7.4588 (2.6); 7.2602 (10.5); 7.2150 (1.5); 7.2106 (1.4); 7.1939 (1.3); 7.1895 (1.2); 7.1137 (3.7);
7.1003 (3.2); 7.0801 (0.4); 6.8557 (0.7); 6.8428 (1.1); 6.8323 (1.2); 6.8217 (0.7); 6.8155 (0.6); 4.4513
(1.1); 4.4358 (1.1); 4.4165 (2.2); 4.4010 (2.2); 4.3817 (1.2); 4.3663 (1.1); 2.9538 (6.2); 2.8820 (5.8);
2.6989 (16.0); 2.1248 (0.6); 2.1166 (0.6); 2.1037 (1.2); 2.0909 (0.7); 2.0825 (0.6); 1.5681 (10.0);
1.0574 (0.7); 1.0454 (2.1); 1.0408 (2.2); 1.0293 (1.2); 1.0242 (2.2); 1.0196 (2.1); 1.0085 (0.8); 0.8028
(0.8); 0.7908 (2.7); 0.7876 (2.5); 0.7784 (2.4); 0.7745 (2.6); 0.7622 (0.7); −0.0002 (2.2)
I-639: ¹H-NMR(400.1 MHz, CDCl3):
δ = 8.3035 (16.0); 8.1249 (1.5); 7.6989 (2.4); 7.6789 (2.4); 7.6409 (0.4); 7.6189 (1.8); 7.6004 (7.1);
7.5945 (6.4); 7.5864 (12.4); 7.5737 (1.7); 7.5424 (1.0); 7.4791 (7.1); 7.4571 (0.6); 7.4312 (0.7);
7.4203 (2.4); 7.4113 (3.4); 7.4062 (3.4); 7.3982 (2.6); 7.3921 (1.7); 7.2606 (7.0); 6.7517 (13.5);
5.2963 (0.4); 5.2784 (1.2); 5.2618 (2.6); 5.2450 (2.5); 5.2283 (1.1); 2.7679 (0.4); 2.7534 (0.7); 2.7262
(2.2); 2.7122 (5.6); 2.6978 (5.7); 2.6848 (2.2); 2.6564 (0.6); 2.2380 (0.7); 2.2257 (1.2); 2.2194 (1.3);
2.2156 (1.3); 2.2065 (1.9); 2.1973 (1.8); 2.1849 (1.8); 2.1776 (1.3); 2.1720 (1.2); 2.1641 (0.9); 1.9610
(1.1); 1.9375 (2.8); 1.9311 (3.4); 1.9229 (4.0); 1.9173 (3.5); 1.9109 (3.0); 1.9038 (2.6); 1.8886 (1.2);
1.8769 (0.6); 1.8643 (1.4); 1.8574 (1.4); 1.8476 (1.5); 1.8408 (1.8); 1.8325 (1.5); 1.8228 (1.5); 1.8156
(1.5); 1.8051 (1.2); 1.7956 (0.8); 1.7858 (0.6); 1.5787 (1.7); 1.2558 (1.0); −0.0002 (3.8)
I-640: ¹H-NMR(300.2 MHz, CDCl3):
δ = 8.2651 (16.0); 8.1173 (1.2); 8.0984 (2.0); 8.0800 (1.2); 7.6755 (5.7); 7.4919 (3.3); 7.4636 (8.5);
7.4305 (6.9); 7.4039 (8.0); 7.3774 (3.9); 7.3045 (39.0); 7.1008 (3.8); 7.0746 (3.2); 7.0119 (2.7);
7.0087 (2.7); 7.0039 (3.3); 6.9849 (2.2); 6.9818 (2.3); 6.9770 (3.2); 6.9437 (4.6); 6.9380 (5.5); 6.9312
(2.9); 5.3441 (10.2); 4.4823 (2.5); 4.4618 (2.5); 4.4345 (5.4); 4.4140 (5.2); 4.3867 (2.7); 4.3663 (2.6);
2.0325 (0.6); 2.0161 (1.3); 2.0048 (1.5); 1.9882 (2.8); 1.9714 (1.6); 1.9601 (1.5); 1.9433 (0.8); 1.5917
(19.4); 1.3001 (0.4); 1.0999 (1.8); 1.0846 (4.9); 1.0777 (5.4); 1.0624 (3.1); 1.0562 (5.3); 1.0499 (4.7);
1.0348 (2.3); 1.0129 (0.3); 0.8098 (2.2); 0.7942 (6.4); 0.7889 (5.2); 0.7777 (5.2); 0.7723 (6.4); 0.7557
(1.8); 0.1133 (0.5); 0.0544 (1.4); 0.0436 (40.2); 0.0326 (1.5)
I-641: ¹H-NMR(400.0 MHz, d₆-DMSO):
δ = 8.6706 (2.6); 7.9528 (0.7); 7.7298 (0.5); 7.7101 (1.6); 7.6903 (1.3); 7.6608 (1.8); 7.6522 (5.2);
7.6420 (0.9); 7.5709 (2.1); 7.5249 (1.2); 7.5046 (0.9); 7.1563 (3.2); 7.1349 (3.5); 6.6423 (3.7); 6.6209
(3.4); 3.5998 (16.0); 3.3273 (21.1); 2.8906 (4.6); 2.8443 (5.3); 2.7317 (4.1); 2.5685 (13.1); 2.5063
(16.6); 2.5021 (21.5); 2.4977 (15.5); 1.2400 (0.6); 0.8332 (0.8); 0.8154 (2.9); 0.8044 (1.2); 0.7244
(1.2); 0.7132 (2.8); 0.6960 (0.8); −0.0002 (3.0)
I-642: ¹H-NMR(300.2 MHz, CDCl3):
δ = 7.5690 (2.1); 7.5517 (1.4); 7.5404 (2.8); 7.5284 (4.1); 7.5176 (2.3); 7.5111 (2.3); 7.4256 (1.9);
7.3883 (0.8); 7.3803 (1.4); 7.3731 (0.8); 7.3670 (0.5); 7.3642 (0.5); 7.3580 (0.8); 7.3505 (0.5); 7.2985
(2.6); 7.2209 (1.3); 7.2142 (1.2); 7.1927 (1.1); 7.1860 (1.0); 6.5181 (0.5); 6.4968 (1.0); 6.4755 (0.5);
4.4583 (0.9); 4.4368 (0.9); 4.4101 (2.0); 4.3886 (1.9); 4.3619 (1.0); 4.3404 (0.9); 2.4143 (16.0);
2.0930 (0.6); 2.0823 (0.6); 2.0764 (0.4); 2.0661 (1.3); 2.0550 (0.5); 2.0494 (0.7); 2.0387 (0.7); 2.0222
(0.3); 1.6457 (1.2); 1.3015 (1.0); 1.2948 (0.9); 1.2517 (6.6); 1.2373 (0.7); 1.2218 (1.8); 1.2138 (2.2);
1.2057 (1.8); 1.2024 (1.6); 1.1975 (2.0); 1.1858 (0.9); 1.0981 (0.9); 1.0865 (2.0); 1.0780 (1.5); 1.0712
(1.2); 1.0594 (1.9); 1.0507 (1.5); 1.0358 (0.6); 0.9382 (0.3); 0.9166 (1.0); 0.8932 (0.4); 0.1079 (1.0);
0.0349 (2.1)
I-643: ¹H-NMR(400.1 MHz, d₆-DMSO):
δ = 9.1089 (1.3); 9.0947 (2.8); 9.0805 (1.6); 8.8573 (8.1); 8.7191 (4.2); 8.7067 (4.7); 8.2389 (9.1);
8.0898 (0.8); 7.9606 (3.0); 7.8008 (0.9); 7.7717 (4.8); 7.7630 (4.1); 7.7409 (4.1); 7.7315 (5.4); 7.7193
(5.9); 7.6864 (3.2); 7.6665 (2.1); 7.6340 (5.1); 7.6113 (0.5); 7.5870 (3.7); 7.5660 (4.5); 7.5503 (0.7);
7.3690 (2.5); 7.3645 (2.9); 7.3483 (2.3); 7.3438 (2.5); 6.1030 (0.8); 6.0906 (1.5); 6.0783 (0.9); 5.9878
(0.7); 5.9757 (1.5); 5.9632 (0.9); 3.9395 (1.9); 3.9250 (1.4); 3.8977 (1.3); 3.8828 (2.1); 3.8681 (1.4);
3.8410 (0.4); 3.3320 (171.7); 2.8989 (16.0); 2.7394 (15.0); 2.5102 (21.6)
I-644: ¹H-NMR(400.1 MHz, CDCl3):
δ = 8.0752 (5.4); 8.0306 (1.0); 8.0162 (1.1); 7.3498 (2.1); 7.3299 (2.3); 7.2594 (9.7); 7.1037 (3.5);
7.0908 (2.6); 7.0856 (2.7); 7.0710 (0.5); 7.0157 (2.5); 6.9290 (1.3); 6.9091 (1.3); 6.8487 (0.7); 6.8335
(1.1); 6.8249 (1.3); 6.8156 (0.7); 6.8085 (0.6); 4.2536 (1.0); 4.2387 (1.0); 4.2180 (2.2); 4.2030 (2.2);
4.1823 (1.2); 4.1674 (1.1); 2.9533 (4.1); 2.8820 (3.8); 2.7012 (16.0); 2.4777 (7.0); 2.2632 (9.8);
2.1247 (0.6); 2.1164 (0.6); 2.1036 (1.2); 2.0907 (0.7); 2.0825 (0.7); 2.0693 (0.4); 1.5662 (8.8); 1.0492
(0.7); 1.0374 (2.1); 1.0326 (2.2); 1.0213 (1.2); 1.0162 (2.2); 1.0115 (2.1); 1.0004 (0.9); 0.7982 (0.8);
0.7864 (2.6); 0.7828 (2.4); 0.7740 (2.3); 0.7699 (2.7); 0.7577 (0.8); −0.0002 (2.1)
I-645: ¹H-NMR(300.2 MHz, CDCl3):
δ = 7.3699 (3.6); 7.3432 (4.1); 7.2986 (29.1); 7.1663 (0.6); 7.1042 (1.2); 7.0757 (3.2); 7.0608 (3.0);
7.0524 (7.7); 7.0383 (6.2); 7.0324 (6.9); 7.0119 (1.8); 7.0049 (1.4); 6.9240 (2.1); 6.8979 (1.9); 6.8248
(1.3); 6.8149 (1.3); 6.8026 (2.4); 6.7951 (1.9); 6.7773 (1.2); 6.7712 (1.1); 4.2508 (2.0); 4.2307 (1.9);
4.2026 (4.2); 4.1825 (4.1); 4.1541 (2.2); 4.1341 (2.0); 3.0529 (0.7); 3.0425 (1.2); 3.0300 (1.5); 3.0206
(1.6); 3.0079 (1.2); 2.9981 (0.7); 2.5269 (0.5); 2.4938 (11.8); 2.4865 (6.5); 2.3832 (0.6); 2.2984
(16.0); 2.1558 (0.4); 2.1382 (0.9); 2.1278 (1.0); 2.1103 (1.9); 2.0930 (1.1); 2.0832 (2.1); 2.0645 (0.5);
1.5843 (12.6); 1.3447 (0.5); 1.3214 (1.2); 1.3061 (3.3); 1.2981 (3.2); 1.2742 (0.5); 1.0715 (1.3);
1.0563 (3.6); 1.0494 (3.9); 1.0435 (2.0); 1.0348 (2.2); 1.0276 (3.8); 1.0210 (3.5); 1.0066 (1.8); 0.9427
(1.3); 0.9209 (4.0); 0.8971 (2.2); 0.8784 (2.9); 0.8721 (3.9); 0.8551 (4.0); 0.8490 (3.3); 0.8316 (1.4);
0.8148 (2.0); 0.7999 (4.4); 0.7936 (4.2); 0.7827 (4.0); 0.7772 (4.7); 0.7608 (1.5); 0.7008 (1.5); 0.6846
(3.5); 0.6769 (4.1); 0.6720 (3.4); 0.6652 (2.9); 0.6484 (0.9); 0.0496 (1.2); 0.0388 (37.6); 0.0279 (1.3)
I-646: ¹H-NMR(400.2 MHz, d₆-DMSO):
δ = 9.4411 (2.4); 9.4220 (2.4); 8.3163 (0.4); 8.2405 (16.0); 7.7450 (5.3); 7.7227 (2.5); 7.6102 (1.1);
7.5907 (4.0); 7.5832 (3.5); 7.5648 (2.7); 7.5457 (0.9); 7.4821 (0.5); 7.4769 (0.6); 7.4617 (1.1); 7.4567
(1.3); 7.4481 (0.8); 7.4428 (1.0); 7.4389 (1.7); 7.4312 (1.0); 7.4181 (0.8); 7.4134 (0.7); 7.3670 (0.6);
7.3628 (0.6); 7.3460 (1.3); 7.3421 (1.4); 7.3293 (1.6); 7.3249 (1.2); 7.3186 (1.8); 7.3166 (1.8); 7.3114
(4.0); 7.3038 (1.3); 7.2996 (1.9); 7.2792 (0.7); 5.2553 (0.4); 5.2380 (1.5); 5.2201 (2.3); 5.2020 (1.5);
5.1844 (0.4); 3.9031 (1.4); 3.7055 (0.7); 3.3325 (304.4); 3.1751 (0.4); 3.1621 (0.4); 2.6761 (1.1);
2.6715 (1.6); 2.6670 (1.1); 2.6625 (0.6); 2.5370 (1.4); 2.5249 (5.4); 2.5201 (8.6); 2.5115 (103.6);
2.5071 (206.4); 2.5026 (266.6); 2.4980 (191.0); 2.4935 (92.7); 2.4585 (0.7); 2.3383 (0.6); 2.3339
(1.1); 2.3293 (1.6); 2.3249 (1.1); 2.3204 (0.6); 1.4913 (10.9); 1.4737 (10.9); 1.4433 (0.4); 1.2345
(0.4); −0.0002 (1.1)
I-647: ¹H-NMR(499.9 MHz, CDCl3):
δ = 8.2196 (16.0); 7.6557 (3.0); 7.6166 (2.2); 7.6008 (8.6); 7.5962 (7.3); 7.5796 (5.9); 7.5637 (2.3);
7.5572 (2.1); 7.5385 (0.4); 7.4888 (1.4); 7.4270 (1.0); 7.4125 (2.3); 7.3956 (2.7); 7.3544 (12.2);
7.3382 (13.0); 7.2787 (3.4); 7.2648 (4.1); 7.2599 (14.6); 7.1768 (10.4); 7.1719 (14.1); 7.1549 (10.0);
7.0193 (4.2); 7.0040 (4.7); 3.8334 (1.0); 3.8237 (1.4); 3.8136 (2.0); 3.8026 (2.2); 3.7933 (2.3); 3.7823
(2.0); 3.7735 (1.5); 3.7625 (1.0); 3.4187 (0.4); 3.4070 (0.6); 3.4008 (0.5); 3.3974 (0.5); 3.3911 (0.6);
3.3796 (0.4); 2.0673 (1.9); 2.0496 (3.3); 2.0410 (0.6); 2.0308 (2.4); 2.0253 (2.1); 2.0074 (3.2); 1.9888
(2.0); 1.8102 (0.3); 1.7928 (0.7); 1.7835 (0.4); 1.7752 (0.4); 1.7661 (0.7); 1.7486 (0.4); 1.6682 (0.4);
1.6558 (0.5); 1.6511 (0.4); 1.6387 (0.4); 1.6237 (0.5); 1.6112 (0.6); 1.6023 (2.2); 1.5904 (2.7); 1.5849
(2.9); 1.5817 (2.8); 1.5729 (3.1); 1.5698 (3.3); 1.5640 (3.5); 1.5542 (6.0); 1.2567 (0.9); −0.0002 (14.0)
I-648: ¹H-NMR(400.1 MHz, CDCl3):
δ = 7.5170 (0.6); 7.4972 (2.9); 7.4816 (7.6); 7.3747 (4.0); 7.3453 (0.4); 7.3326 (1.5); 7.3258 (2.4);
7.3202 (2.0); 7.3106 (5.0); 7.2908 (3.7); 7.2579 (5.3); 7.0037 (4.3); 6.9282 (1.5); 6.8941 (2.5); 6.8741
(2.2); 6.7800 (0.6); 5.2932 (0.8); 4.1812 (1.6); 4.1663 (1.6); 4.1444 (3.4); 4.1295 (3.2); 4.1076 (1.8);
4.0927 (1.6); 2.9623 (0.7); 2.9546 (1.2); 2.9457 (1.6); 2.9384 (1.6); 2.9295 (1.2); 2.9217 (0.8); 2.4433
(11.8); 2.2609 (16.0); 1.5835 (0.9); 1.2573 (1.5); 0.8449 (1.0); 0.8274 (4.0); 0.8136 (4.1); 0.7969
(1.2); 0.6624 (1.3); 0.6494 (3.8); 0.6447 (4.3); 0.6232 (1.0); −0.0002 (4.2)
I-649: ¹H-NMR(300.2 MHz, CDCl3):
δ = 8.7591 (2.1); 8.7418 (2.2); 7.6174 (0.3); 7.5915 (1.4); 7.5686 (4.7); 7.5460 (0.5); 7.5160 (2.4);
7.4851 (1.1); 7.4770 (1.8); 7.4636 (3.4); 7.4451 (3.1); 7.4079 (2.0); 7.3813 (2.3); 7.2988 (5.0); 7.0950
(2.4); 7.0100 (1.3); 6.9837 (1.1); 6.8151 (0.5); 6.7950 (1.0); 6.7751 (0.5); 4.3245 (0.8); 4.3041 (0.8);
4.2755 (1.6); 4.2550 (1.6); 4.2263 (0.8); 4.2059 (0.8); 2.5381 (7.0); 2.3447 (16.0); 2.3277 (9.8);
2.0724 (0.4); 1.2915 (0.6); 0.1092 (0.4); 0.0355 (4.9)
I-650: ¹H-NMR(300.2 MHz, CDCl3):
δ = 8.2640 (1.2); 7.5680 (0.5); 7.5414 (1.9); 7.5199 (5.3); 7.4984 (0.6); 7.4368 (1.4); 7.4187 (0.9);
7.4046 (0.7); 7.3815 (3.1); 7.3627 (1.3); 7.3540 (2.0); 7.3444 (3.3); 7.3328 (1.5); 7.3177 (3.1); 7.2986
(17.8); 7.0786 (0.6); 7.0374 (2.9); 6.9255 (1.6); 6.8985 (1.4); 5.3373 (1.8); 4.2375 (1.3); 4.2177 (1.2);
4.1892 (2.8); 4.1695 (2.6); 4.1411 (1.5); 4.1213 (1.4); 4.0826 (0.4); 4.0619 (0.3); 3.1686 (0.5); 3.1581
(0.9); 3.1463 (1.2); 3.1359 (1.2); 3.1235 (0.9); 3.1133 (0.6); 2.5125 (1.3); 2.4871 (8.4); 2.3856 (0.4);
2.3589 (2.4); 2.3416 (1.7); 2.3242 (1.2); 2.3139 (1.6); 2.2965 (11.7); 1.6037 (16.0); 1.3743 (0.4);
1.2933 (5.3); 1.2226 (1.1); 1.2077 (2.7); 1.2000 (3.0); 1.1909 (2.9); 1.1832 (2.9); 1.1707 (1.3); 1.1371
(0.4); 1.0314 (1.2); 1.0189 (2.7); 1.0108 (2.5); 1.0044 (1.7); 0.9917 (2.7); 0.9835 (2.4); 0.9691 (0.9);
0.9261 (1.1); 0.9180 (1.0); 0.9026 (3.1); 0.8856 (3.3); 0.8797 (2.7); 0.8628 (1.4); 0.7472 (1.1); 0.7314
(2.6); 0.7233 (3.0); 0.6950 (0.7); 0.1077 (12.0); 0.0957 (0.6); 0.0486 (0.8); 0.0378 (15.9)
I-651: ¹H-NMR(400.1 MHz, d₆-DMSO):
δ = 9.1059 (1.1); 9.0913 (2.4); 9.0766 (1.4); 8.8564 (7.6); 8.7185 (4.0); 8.7062 (4.4); 8.2616 (0.4);
8.2324 (8.4); 8.0850 (0.7); 7.9604 (2.8); 7.8019 (0.8); 7.7799 (4.7); 7.7627 (3.1); 7.7497 (5.9); 7.7309
(4.9); 7.7187 (5.3); 7.6863 (2.6); 7.6659 (1.8); 7.6278 (0.3); 7.6233 (0.4); 7.5185 (0.9); 7.4973 (6.6);
7.4685 (0.9); 6.0878 (0.7); 6.0757 (1.4); 6.0630 (0.8); 5.9730 (0.7); 5.9606 (1.4); 5.9479 (0.8); 3.9439
(0.9); 3.9343 (1.8); 3.9195 (1.2); 3.8879 (1.1); 3.8777 (1.9); 3.8638 (1.2); 3.3289 (188.0); 2.8985
(16.0); 2.7393 (14.9); 2.5095 (19.4)
I-652: ¹H-NMR(400.1 MHz, CDCl3):
δ = 8.4147 (3.5); 8.4104 (3.5); 8.3322 (3.5); 8.3258 (3.5); 8.2381 (8.5); 8.0144 (2.1); 7.9179 (0.6);
7.9038 (1.0); 7.8893 (0.6); 7.6403 (3.3); 7.4674 (1.4); 7.4462 (5.0); 7.4330 (3.0); 7.4291 (2.8); 7.4118
(0.8); 7.4080 (0.8); 7.2604 (18.0); 7.2191 (2.0); 7.2137 (3.2); 7.2083 (2.0); 4.4312 (1.3); 4.4158 (1.2);
4.3948 (2.8); 4.3795 (2.7); 4.3584 (1.4); 4.3431 (1.3); 2.9535 (16.0); 2.8807 (14.5); 2.0227 (0.4);
2.0099 (0.8); 2.0014 (0.8); 1.9888 (1.6); 1.9764 (0.9); 1.9679 (0.8); 1.9551 (0.4); 1.5675 (17.1);
1.1338 (1.0); 1.1213 (2.6); 1.1173 (2.7); 1.1050 (1.4); 1.1003 (2.7); 1.0962 (2.5); 1.0842 (1.1); 0.8125
(1.1); 0.8002 (3.5); 0.7966 (2.9); 0.7878 (2.7); 0.7839 (3.5); 0.7713 (1.0); −0.0002 (0.8)
I-653: ¹H-NMR(300.2 MHz, CDCl3):
δ = 8.9078 (5.0); 7.8091 (0.4); 7.7895 (0.8); 7.7696 (0.4); 7.5635 (1.1); 7.5376 (2.9); 7.5311 (1.6);
7.5106 (0.5); 7.4917 (1.8); 7.4634 (0.8); 7.4565 (1.3); 7.4494 (0.6); 7.4384 (0.5); 7.4325 (0.8); 7.4227
(1.8); 7.3957 (1.8); 7.2987 (2.3); 7.0882 (1.8); 7.0367 (1.0); 7.0100 (0.9); 4.2656 (0.8); 4.2453 (0.8);
4.2156 (1.8); 4.1954 (1.7); 4.1657 (0.9); 4.1454 (0.9); 3.7418 (1.6); 3.7230 (2.9); 3.7038 (1.8); 3.3685
(16.0); 2.9800 (1.7); 2.9609 (2.8); 2.9421 (1.5); 2.5348 (5.5); 2.5280 (3.1); 2.3226 (7.3); 1.6930 (2.1);
0.0363 (2.0)
I-654: ¹H-NMR(400.1 MHz, d₆-DMSO):
δ = 9.2398 (2.0); 9.2242 (4.4); 9.2085 (2.3); 8.8513 (13.7); 8.7126 (7.4); 8.7003 (7.8); 8.1504 (16.0);
8.0292 (1.3); 7.9601 (1.7); 7.8018 (1.4); 7.7820 (4.4); 7.7629 (10.9); 7.7443 (6.4); 7.7246 (10.0);
7.7137 (9.0); 7.7011 (7.8); 7.6485 (4.0); 7.6288 (3.6); 7.6081 (0.6); 7.5933 (6.1); 7.5719 (7.3); 7.5564
(1.2); 7.2631 (3.8); 7.2589 (4.0); 7.2422 (3.7); 7.2376 (3.7); 4.3440 (1.8); 4.3281 (2.0); 4.3098 (4.2);
4.2938 (4.2); 4.2757 (2.6); 4.2599 (2.4); 3.3357 (281.8); 2.8982 (9.7); 2.7388 (9.0); 2.5098 (32.2);
2.5059 (25.6); 1.2427 (0.5)
I-655: ¹H-NMR(499.9 MHz, d₆-DMSO):
δ = 9.3667 (0.8); 9.3542 (1.7); 9.3417 (0.8); 7.3396 (2.2); 7.3236 (2.5); 7.1746 (0.8); 7.1587 (2.0);
7.1428 (1.4); 7.0988 (2.6); 7.0909 (1.1); 7.0770 (1.4); 7.0627 (0.7); 7.0599 (0.6); 6.9851 (1.4); 6.9692
(1.2); 6.9423 (0.8); 6.9397 (0.8); 6.9267 (1.4); 6.9133 (0.7); 4.1569 (0.6); 4.1444 (0.7); 4.1270 (1.5);
4.1144 (1.4); 4.0969 (0.8); 4.0844 (0.7); 3.3290 (90.6); 2.5266 (0.5); 2.5229 (0.6); 2.5121 (10.7);
2.5087 (21.8); 2.5051 (29.4); 2.5016 (21.0); 2.4982 (9.8); 2.4413 (7.0); 2.2352 (9.9); 2.2092 (16.0);
2.0762 (7.7); 2.0645 (1.2); 2.0542 (0.7); 2.0477 (0.6); 1.0412 (0.8); 1.0325 (2.2); 1.0282 (2.3); 1.0246
(1.2); 1.0198 (1.2); 1.0156 (2.2); 1.0113 (2.3); 1.0031 (0.8); 0.7944 (0.9); 0.7859 (2.5); 0.7821 (2.6);
0.7758 (2.4); 0.7719 (2.6); 0.7629 (0.8)
I-656: ¹H-NMR(400.1 MHz, d₆-DMSO):
δ = 9.2417 (1.6); 9.2211 (1.6); 8.0772 (6.9); 7.9605 (2.4); 7.2498 (0.6); 7.2459 (0.6); 7.2287 (1.6);
7.2252 (1.5); 7.2077 (1.2); 7.2045 (1.2); 7.1703 (1.1); 7.1522 (1.5); 7.1333 (0.7); 6.9854 (0.9); 6.9823
(0.9); 6.9655 (1.6); 6.9483 (0.9); 6.4946 (3.4); 5.1687 (0.4); 5.1530 (0.8); 5.1353 (0.8); 3.9016 (16.0);
3.3300 (18.3); 2.8981 (14.2); 2.7388 (12.9); 2.5132 (9.6); 2.5091 (12.2); 2.5049 (9.6); 2.4773 (1.0);
2.4502 (0.4); 2.3473 (11.4); 2.0369 (0.4); 2.0201 (0.7); 1.9984 (0.6); 1.9867 (0.4); 1.9066 (0.4);
1.8915 (0.5); 1.8735 (0.6); 1.8567 (0.8); 1.8380 (0.8); 1.8221 (0.6); 1.8165 (0.6); 1.8059 (0.6); 1.7892
(0.6); 1.7672 (0.6); 1.7505 (0.6); 1.7296 (0.5); 1.7140 (0.4)
I-657: ¹H-NMR(499.9 MHz, CDCl3):
δ = 7.6252 (3.2); 7.5474 (0.4); 7.5314 (2.2); 7.5193 (5.7); 7.4917 (0.3); 7.4362 (2.6); 7.4189 (4.0);
7.4123 (3.2); 7.3496 (0.4); 7.3394 (1.0); 7.3341 (1.6); 7.3295 (1.4); 7.3219 (1.3); 7.3056 (2.1); 7.3034
(2.0); 7.2887 (1.6); 7.2862 (1.6); 7.2627 (2.4); 6.7147 (0.8); 6.7022 (1.6); 6.6897 (0.9); 4.3819 (1.0);
4.3692 (1.0); 4.3529 (2.3); 4.3402 (2.2); 4.3240 (1.3); 4.3112 (1.2); 4.0975 (0.6); 4.0832 (0.6); 3.2306
(0.3); 3.2164 (0.8); 3.2022 (1.2); 3.1881 (0.9); 3.1741 (0.4); 2.0238 (2.5); 1.6454 (1.7); 1.3780 (15.7);
1.3638 (16.0); 1.3328 (0.9); 1.3181 (1.8); 1.2611 (1.0); 1.2470 (1.5); 1.2327 (0.8); 1.1139 (0.8);
1.1008 (0.8); 0.8710 (0.4); 0.8563 (0.5); 0.8428 (0.3); −0.0002 (1.9)
I-658: ¹H-NMR(400.1 MHz, CDCl3):
δ = 8.4121 (4.2); 8.4088 (4.2); 8.3287 (3.8); 8.3227 (3.8); 8.2493 (11.2); 8.0136 (2.2); 7.9269 (1.5);
7.9127 (0.9); 7.4777 (4.6); 7.4562 (8.3); 7.4060 (7.9); 7.3847 (4.3); 7.2605 (19.3); 7.2109 (2.9);
7.2055 (4.7); 7.2003 (2.9); 4.2129 (1.9); 4.1978 (1.9); 4.1771 (4.2); 4.1620 (4.0); 4.1412 (2.1); 4.1261
(2.0); 2.9532 (16.0); 2.8803 (14.9); 2.0196 (0.5); 2.0068 (1.1); 1.9983 (1.2); 1.9859 (2.2); 1.9732
(1.3); 1.9648 (1.2); 1.9521 (0.6); 1.5738 (18.8); 1.1318 (1.3); 1.1193 (3.7); 1.1151 (3.9); 1.1028 (2.1);
1.0983 (3.8); 1.0941 (3.6); 1.0821 (1.5); 0.8078 (1.6); 0.7955 (5.0); 0.7919 (4.2); 0.7831 (3.9); 0.7791
(5.0); 0.7666 (1.3); −0.0002 (0.9)
I-659: ¹H-NMR(300.2 MHz, CDCl3):
δ = 8.6837 (3.3); 8.6641 (3.3); 7.6160 (0.4); 7.5899 (1.8); 7.5751 (4.2); 7.5681 (5.3); 7.5469 (3.3);
7.5141 (2.5); 7.5081 (2.7); 7.4880 (2.5); 7.4610 (0.4); 7.4556 (0.4); 7.4426 (1.1); 7.4340 (1.8); 7.4214
(4.9); 7.4163 (3.5); 7.4063 (3.4); 7.4015 (4.4); 7.2985 (2.5); 7.2753 (1.3); 7.2546 (0.7); 7.2289 (1.6);
7.2224 (1.6); 7.2008 (1.4); 7.1942 (1.3); 5.3240 (1.5); 4.4815 (0.9); 4.4603 (0.9); 4.4326 (1.8); 4.4114
(1.8); 4.3836 (0.9); 4.3624 (0.9); 2.3303 (16.0); 2.3132 (0.6); 2.2927 (0.4); 2.0549 (0.5); 1.2870 (0.7);
0.0280 (1.7)
I-660: ¹H-NMR(300.2 MHz, CDCl3):
δ = 9.7825 (1.4); 8.6910 (3.1); 8.6142 (1.7); 8.5991 (1.8); 8.1345 (0.8); 8.1174 (1.4); 7.6508 (0.7);
7.6445 (0.8); 7.6259 (2.6); 7.6066 (6.4); 7.6038 (6.3); 7.5861 (1.1); 7.5461 (2.8); 7.5294 (2.9); 7.5035
(6.0); 7.4760 (6.7); 7.4390 (1.8); 7.4289 (2.5); 7.4213 (2.2); 7.4030 (6.8); 7.3743 (3.6); 7.2987 (74.3);
7.2321 (0.4); 6.9477 (0.5); 5.3383 (0.4); 4.2724 (0.3); 4.2445 (0.8); 4.2221 (0.8); 4.1951 (0.9); 4.1794
(1.3); 4.1619 (0.7); 4.1502 (0.7); 4.1304 (1.4); 4.1129 (1.1); 4.0865 (0.9); 4.0676 (0.9); 2.1299 (0.8);
2.1162 (1.3); 2.1069 (1.3); 2.0932 (1.0); 1.7402 (0.7); 1.6403 (4.6); 1.4857 (0.7); 1.4603 (1.0); 1.4281
(0.6); 1.3738 (1.3); 1.2923 (16.0); 1.1437 (0.9); 1.0619 (0.5); 1.0379 (0.7); 1.0144 (0.6); 0.9744 (0.5);
0.9173 (2.6); 0.8916 (2.6); 0.8634 (1.8); 0.7753 (0.5); 0.7512 (0.5); 0.7258 (0.3); 0.6775 (0.4); 0.6534
(0.6); 0.6427 (0.8); 0.6234 (1.2); 0.6112 (0.8); 0.5884 (0.7); 0.5597 (0.9); 0.5481 (0.7); 0.5395 (0.9);
0.5266 (1.2); 0.5077 (0.9); 0.4849 (0.4); 0.4168 (0.5); 0.3975 (0.8); 0.3818 (1.0); 0.3632 (1.0); 0.3316
(0.4); 0.2324 (0.3); 0.1720 (0.4); 0.1502 (0.9); 0.1317 (0.9); 0.1183 (0.9); 0.1069 (2.1); 0.0479 (2.5);
0.0371 (73.0); 0.0263 (4.0); −0.0292 (0.5); −0.1624 (0.4)
I-661: ¹H-NMR(400.1 MHz, d₆-DMSO):
δ = 9.2387 (1.8); 9.2234 (4.0); 9.2076 (2.1); 9.1876 (0.4); 8.8512 (12.8); 8.8301 (0.6); 8.7130 (7.0);
8.7007 (7.6); 8.1442 (16.0); 8.0961 (0.3); 8.0260 (1.4); 7.9603 (2.3); 7.8738 (6.8); 7.8045 (1.3);
7.7842 (4.0); 7.7640 (4.1); 7.7443 (5.6); 7.7312 (8.0); 7.7137 (7.6); 7.7013 (7.2); 7.6756 (0.5); 7.6488
(3.9); 7.6291 (2.9); 7.5693 (0.4); 7.5513 (0.4); 7.5186 (4.9); 7.4974 (7.1); 7.4817 (0.9); 7.4039 (4.0);
7.3997 (4.1); 7.3831 (3.3); 7.3788 (3.1); 4.3378 (1.6); 4.3219 (1.8); 4.3037 (3.7); 4.2878 (3.7); 4.2694
(2.3); 4.2537 (2.2); 4.2206 (0.3); 3.3333 (291.9); 2.8982 (13.9); 2.7389 (12.6); 2.5137 (23.5); 2.5095
(32.0); 2.5054 (24.6); 1.2420 (0.5)
I-662: ¹H-NMR(400.2 MHz, d₆-DMSO):
δ = 11.2331 (0.7); 9.1405 (0.5); 9.1287 (0.7); 9.1215 (1.1); 9.1062 (2.4); 9.0899 (1.2); 8.3096 (6.2);
7.8264 (9.8); 7.7869 (0.6); 7.7752 (0.6); 7.7501 (1.1); 7.7302 (3.1); 7.7103 (2.8); 7.6855 (3.6); 7.6656
(2.0); 7.6430 (4.2); 7.6071 (0.4); 7.5776 (2.5); 7.5580 (1.8); 7.4401 (0.3); 7.3447 (0.6); 7.3249 (0.8);
7.3151 (3.6); 7.2950 (3.8); 7.1119 (1.2); 7.0919 (0.8); 7.0698 (4.6); 6.9190 (2.2); 6.9010 (2.0); 6.6428
(0.9); 6.4329 (0.5); 5.2202 (0.3); 4.2690 (0.4); 4.2136 (0.4); 4.2008 (0.5); 4.1936 (0.5); 4.1818 (0.4);
4.1319 (1.4); 4.1165 (1.5); 4.0947 (2.9); 4.0791 (2.8); 4.0574 (1.8); 4.0408 (1.5); 4.0150 (0.6); 3.9789
(0.4); 3.9435 (0.6); 3.9173 (0.7); 3.8990 (0.5); 3.8712 (0.4); 3.8655 (0.5); 3.8450 (0.5); 3.8321 (0.5);
3.8068 (0.4); 3.7953 (0.4); 3.7826 (0.4); 3.7592 (0.5); 3.7414 (0.5); 3.7150 (0.6); 3.6886 (0.8); 3.6750
(0.8); 3.6624 (0.7); 3.6528 (0.7); 3.6354 (0.5); 3.6216 (0.5); 3.5732 (0.6); 3.5661 (0.6); 3.4995 (0.9);
3.4760 (1.0); 3.4545 (1.4); 3.3353 (2896.4); 3.2640 (3.2); 3.2463 (6.7); 3.2288 (3.5); 3.0005 (4.0);
2.9831 (7.7); 2.9650 (3.3); 2.8756 (0.5); 2.8314 (0.8); 2.8083 (0.4); 2.7001 (0.8); 2.6808 (3.1); 2.6767
(4.9); 2.6721 (6.8); 2.6676 (5.2); 2.6466 (0.9); 2.6142 (1.1); 2.5930 (1.5); 2.5810 (1.4); 2.5424 (6.4);
2.5255 (16.8); 2.5205 (25.6); 2.5120 (353.2); 2.5077 (716.4); 2.5032 (941.3); 2.4987 (678.9); 2.4944
(328.6); 2.4185 (11.8); 2.3817 (2.4); 2.3606 (0.8); 2.3345 (4.0); 2.3299 (5.5); 2.3256 (4.1); 2.3039
(2.6); 2.2921 (1.3); 2.2202 (16.0); 2.1921 (0.8); 2.0723 (7.5); 1.9638 (0.4); 1.9449 (0.5); 1.4016 (0.5);
1.3787 (0.4); 1.3431 (0.4); 1.2344 (5.3); 0.8549 (0.6); 0.8126 (0.5); 0.7906 (0.4); 0.7717 (0.4); 0.7607
(0.5); 0.7397 (0.6); 0.7208 (0.5); 0.2184 (6.0); 0.2103 (7.8); 0.1595 (0.4); 0.1391 (0.8); 0.1204 (4.8);
0.1169 (4.2); 0.1102 (3.7); 0.0993 (22.8); 0.0931 (9.3); 0.0698 (7.2); 0.0335 (0.4); 0.0080
(1.8); −0.0001 (55.5); −0.0084 (1.8); −0.0230 (2.2); −0.0835 (0.4)
I-663: ¹H-NMR(400.1 MHz, CDCl3):
δ = 8.0033 (1.4); 7.4926 (0.9); 7.4894 (0.9); 7.4733 (1.6); 7.4571 (1.0); 7.3484 (2.4); 7.3283 (2.6);
7.2600 (15.5); 7.2422 (1.8); 7.2247 (1.1); 7.1152 (1.2); 7.0947 (1.9); 7.0740 (0.9); 7.0538 (3.3);
6.9417 (1.8); 6.9217 (1.6); 6.3956 (0.7); 6.3797 (1.1); 6.3664 (0.6); 6.0433 (0.6); 6.0350 (0.7); 6.0265
(0.7); 6.0180 (0.6); 5.9274 (0.6); 5.9190 (0.7); 5.9105 (0.7); 5.9023 (0.6); 4.2138 (0.3); 4.2048 (0.3);
4.1967 (0.4); 4.1891 (0.3); 4.1768 (0.4); 4.1685 (0.4); 4.1607 (0.4); 4.1506 (0.6); 4.1333 (0.3); 4.1245
(0.3); 4.1130 (0.4); 4.1046 (0.4); 4.0967 (0.4); 4.0878 (0.4); 3.9286 (0.4); 3.9141 (0.5); 3.8971 (0.4);
3.8752 (0.7); 3.8601 (0.8); 3.8429 (0.4); 3.8384 (0.4); 3.8225 (0.4); 2.9517 (9.1); 2.8757 (8.6); 2.4081
(16.0); 1.8676 (0.3); 1.8548 (0.7); 1.8463 (0.8); 1.8342 (1.3); 1.8216 (0.8); 1.8139 (0.7); 1.8008 (0.4);
1.5588 (15.8); 1.0195 (0.9); 1.0074 (2.4); 1.0028 (2.5); 0.9865 (2.4); 0.9822 (2.2); 0.9707 (0.8);
0.6884 (1.0); 0.6764 (3.1); 0.6642 (2.6); 0.6602 (2.9); 0.6479 (0.8); −0.0002 (14.9)
I-664: ¹H-NMR(499.9 MHz, CDCl3):
δ = 8.2259 (0.4); 7.3480 (0.3); 7.3342 (3.4); 7.3182 (3.6); 7.2621 (5.1); 7.1000 (1.1); 7.0840 (2.9);
7.0679 (2.9); 7.0580 (2.0); 7.0541 (2.2); 7.0438 (2.2); 7.0411 (2.5); 7.0253 (5.4); 6.9182 (2.4); 6.9026
(2.1); 6.8390 (1.6); 6.8351 (1.9); 6.8244 (3.3); 6.8105 (2.4); 6.8073 (2.1); 5.2965 (2.4); 4.2133 (1.8);
4.2064 (1.0); 4.2010 (1.8); 4.1940 (1.0); 4.1850 (3.7); 4.1726 (3.5); 4.1566 (1.9); 4.1443 (1.7); 3.0293
(5.8); 3.0144 (13.2); 3.0053 (4.2); 2.9995 (5.6); 2.9379 (1.6); 2.4744 (12.3); 2.3439 (0.4); 2.2899
(0.6); 2.2635 (16.0); 2.2420 (0.9); 2.2301 (6.2); 2.2215 (6.9); 2.2151 (14.5); 2.2087 (5.9); 2.2001
(5.1); 2.1906 (0.6); 2.1010 (0.6); 2.0907 (1.2); 2.0840 (1.3); 2.0739 (2.0); 2.0636 (1.3); 2.0570 (1.2);
2.0466 (0.6); 1.6143 (1.2); 1.2554 (0.5); 1.0491 (0.4); 1.0390 (1.6); 1.0298 (4.0); 1.0260 (3.9); 1.0168
(2.7); 1.0128 (4.2); 1.0090 (3.8); 1.0000 (1.7); 0.9871 (0.3); 0.7927 (0.3); 0.7895 (0.4); 0.7791 (2.0);
0.7697 (4.9); 0.7666 (4.6); 0.7597 (4.3); 0.7564 (4.6); 0.7466 (1.6); −0.0002 (7.1)
I-665: ¹H-NMR(400.1 MHz, d₆-DMSO):
δ = 9.1021 (1.5); 9.0871 (3.0); 9.0728 (1.6); 8.0478 (12.4); 7.9609 (2.5); 7.6516 (4.8); 7.5684 (4.5);
7.5474 (5.6); 7.5180 (1.6); 7.4989 (3.0); 7.4782 (1.9); 7.3699 (3.2); 7.3649 (3.2); 7.3490 (2.8); 7.3439
(2.7); 7.1892 (13.2); 7.1716 (4.0); 7.1662 (4.8); 6.0607 (0.9); 6.0475 (1.7); 6.0358 (1.0); 5.9453 (0.9);
5.9325 (1.8); 5.9204 (1.0); 3.8949 (1.5); 3.8801 (2.4); 3.8711 (1.4); 3.8645 (1.2); 3.8372 (1.9); 3.8227
(2.8); 3.8115 (1.4); 3.3363 (157.4); 2.8986 (16.0); 2.7392 (14.2); 2.5143 (14.3); 2.5101 (19.8); 2.5059
(15.5); 1.5680 (0.9); 1.5522 (3.3); 1.5481 (3.5); 1.5331 (1.4); 1.5196 (1.2); 1.5035 (3.4); 1.4993 (3.6);
1.4848 (1.5); 1.2302 (1.1); 1.2141 (3.5); 1.2090 (4.2); 1.1913 (4.3); 1.1868 (3.8); 1.1706 (1.2)
I-666: ¹H-NMR(400.1 MHz, d₆-DMSO):
δ = 8.8152 (1.0); 8.8015 (2.0); 8.7873 (1.1); 8.0559 (6.8); 7.9609 (0.8); 7.4756 (1.3); 7.4561 (2.9);
7.4367 (1.8); 7.2362 (2.3); 7.2170 (2.0); 7.1762 (5.3); 7.1547 (1.9); 7.0533 (2.5); 7.0342 (3.0); 6.9408
(3.7); 6.8231 (2.0); 6.8044 (1.8); 3.4757 (1.1); 3.4588 (2.6); 3.4412 (2.8); 3.4249 (1.4); 3.3376 (80.4);
3.1251 (0.6); 3.1030 (0.8); 3.0941 (1.1); 3.0694 (1.1); 3.0418 (0.7); 2.8989 (4.6); 2.8083 (2.2); 2.7896
(3.8); 2.7718 (2.2); 2.7396 (4.3); 2.5107 (11.6); 2.2661 (16.0); 2.1918 (14.6); 2.0509 (0.6); 2.0353
(0.7); 2.0211 (1.5); 2.0056 (1.8); 1.9938 (1.9); 1.9849 (1.1); 1.9747 (1.3); 1.9629 (0.9)
I-667: ¹H-NMR(400.1 MHz, CDCl3):
δ = 7.9973 (1.5); 7.4968 (0.8); 7.4937 (0.9); 7.4774 (1.6); 7.4646 (2.7); 7.4449 (2.5); 7.2738 (3.0);
7.2601 (12.8); 7.2342 (0.8); 7.2309 (0.8); 7.2139 (1.6); 7.1967 (1.0); 7.1166 (1.1); 7.1135 (1.0);
7.0962 (1.7); 7.0930 (1.6); 7.0759 (0.7); 7.0726 (0.7); 6.9885 (1.5); 6.9684 (1.4); 6.3962 (0.6); 6.3818
(1.0); 6.3667 (0.6); 4.4413 (1.0); 4.4253 (1.1); 4.4058 (2.2); 4.3898 (2.1); 4.3701 (1.1); 4.3542 (1.0);
2.9504 (10.0); 2.8725 (9.4); 2.3798 (16.0); 2.3077 (10.3); 2.2031 (0.4); 1.5610 (13.6); −0.0002 (13.1)
I-668: ¹H-NMR(400.1 MHz, CDCl3):
δ = 7.9959 (0.6); 7.4978 (0.8); 7.4945 (0.8); 7.4783 (1.5); 7.4743 (1.0); 7.4625 (0.9); 7.4589 (0.9);
7.4033 (2.5); 7.3344 (1.6); 7.3133 (3.0); 7.2687 (2.1); 7.2596 (17.5); 7.2319 (0.7); 7.2286 (0.8);
7.2115 (1.6); 7.1944 (1.0); 7.1910 (0.9); 7.1211 (1.1); 7.1177 (1.0); 7.1007 (1.7); 7.0973 (1.6); 7.0801
(0.7); 7.0771 (0.7); 6.4306 (0.6); 6.4164 (1.0); 6.4020 (0.6); 4.2430 (1.0); 4.2269 (1.0); 4.2071 (2.1);
4.1911 (2.0); 4.1712 (1.1); 4.1552 (1.0); 2.9507 (4.5); 2.8721 (4.2); 2.5255 (7.3); 2.3610 (16.0);
1.5520 (19.1); −0.0002 (17.6)
I-669: ¹H-NMR(400.1 MHz, CDCl3):
δ = 8.0112 (0.7); 7.4912 (0.9); 7.4752 (1.5); 7.4593 (0.9); 7.4561 (0.8); 7.3617 (2.1); 7.3420 (2.4);
7.2594 (34.3); 7.2433 (1.9); 7.2261 (1.0); 7.2227 (1.0); 7.1875 (2.7); 7.1180 (1.0); 7.1148 (1.0);
7.0978 (1.7); 7.0943 (1.7); 7.0773 (0.8); 7.0455 (1.6); 7.0242 (1.4); 6.3381 (0.9); 6.0595 (0.5); 6.0523
(0.6); 6.0443 (0.6); 6.0349 (0.5); 5.9432 (0.5); 5.9349 (0.6); 5.9278 (0.6); 5.9187 (0.6); 4.2146 (0.3);
4.1873 (0.4); 4.1778 (0.4); 4.1702 (0.4); 4.1609 (0.6); 4.1514 (0.3); 4.1438 (0.3); 4.1231 (0.4); 4.1148
(0.4); 4.1068 (0.4); 4.0978 (0.4); 3.9480 (0.4); 3.9326 (0.5); 3.9155 (0.4); 3.8931 (0.7); 3.8782 (0.7);
3.8614 (0.4); 3.8407 (0.4); 2.9532 (5.2); 2.8796 (4.8); 2.4186 (16.0); 2.3015 (11.2); 1.5477
(27.7); −0.0002 (34.2)
I-670: ¹H-NMR(400.1 MHz, CDCl3):
δ = 7.9957 (1.5); 7.4823 (1.0); 7.4643 (1.7); 7.4467 (1.1); 7.2795 (2.5); 7.2597 (12.0); 7.2496 (2.2);
7.2299 (1.2); 7.1062 (1.3); 7.0860 (2.1); 7.0654 (1.0); 7.0160 (1.9); 6.9945 (2.0); 6.9848 (3.3); 6.5205
(0.7); 6.5072 (1.1); 6.4926 (0.7); 5.9250 (0.6); 5.9176 (0.7); 5.9049 (0.7); 5.8971 (0.7); 5.8057 (0.6);
5.7987 (0.7); 5.7864 (0.7); 5.7785 (0.6); 4.1548 (0.3); 4.1474 (0.4); 4.1366 (0.4); 4.1297 (0.4); 4.1181
(0.4); 4.1105 (0.4); 4.1009 (0.4); 4.0932 (0.4); 4.0828 (0.4); 4.0747 (0.4); 4.0645 (0.3); 4.0568 (0.4);
4.0453 (0.4); 4.0375 (0.4); 4.0278 (0.4); 4.0202 (0.4); 3.7602 (0.4); 3.7471 (0.4); 3.7399 (0.4); 3.7252
(0.6); 3.7138 (0.5); 3.7025 (0.7); 3.6918 (0.5); 3.6807 (0.6); 3.6650 (0.3); 3.6583 (0.3); 2.9490 (8.7);
2.8712 (8.5); 2.4374 (16.0); 2.3636 (13.7); 2.2923 (12.4); 1.5659 (10.8); −0.0002 (9.3); −0.0015 (9.2)
I-671: ¹H-NMR(400.1 MHz, CDCl3):
δ = 7.9822 (1.6); 7.5465 (3.2); 7.4992 (0.9); 7.4961 (0.9); 7.4798 (1.5); 7.4638 (1.0); 7.4605 (0.9);
7.3538 (7.7); 7.2609 (7.8); 7.2365 (1.7); 7.2194 (1.0); 7.2163 (1.0); 7.1243 (1.1); 7.1211 (1.1); 7.1038
(1.8); 7.1007 (1.7); 7.0833 (0.8); 7.0801 (0.7); 6.5537 (0.6); 6.5398 (1.1); 6.5256 (0.6); 6.0270 (0.6);
6.0189 (0.7); 6.0101 (0.7); 6.0021 (0.6); 5.9109 (0.6); 5.9028 (0.7); 5.8941 (0.7); 5.8860 (0.6); 4.1618
(0.4); 4.1534 (0.4); 4.1453 (0.4); 4.1367 (0.5); 4.1182 (0.3); 4.0973 (0.4); 4.0894 (0.4); 4.0813 (0.4);
4.0733 (0.4); 3.9544 (0.4); 3.9386 (0.6); 3.9225 (0.4); 3.9179 (0.4); 3.9001 (0.6); 3.8830 (0.7); 3.8663
(0.4); 3.8617 (0.4); 3.8454 (0.4); 2.9480 (10.7); 2.8648 (10.0); 2.4083 (16.0); 1.5783 (8.3); −0.0002 (7.6)
I-672: ¹H-NMR(499.9 MHz, CDCl3):
δ = 8.2714 (16.0); 8.0546 (1.0); 8.0444 (1.6); 7.5095 (2.3); 7.5016 (1.8); 7.4938 (6.0); 7.4779 (4.5);
7.4692 (0.7); 7.4666 (0.6); 7.4517 (4.6); 7.4360 (2.3); 7.4131 (5.0); 7.3961 (9.4); 7.3899 (4.2); 7.3510
(0.5); 7.3469 (0.4); 7.3342 (0.4); 7.3301 (0.5); 7.3119 (3.2); 7.3081 (5.0); 7.3046 (3.3); 7.2598 (58.0);
7.2068 (3.5); 7.2027 (3.4); 7.1900 (3.0); 7.1860 (2.9); 7.1775 (2.3); 7.1756 (2.5); 7.1730 (2.4); 7.1711
(2.2); 7.1617 (2.0); 7.1597 (2.2); 7.1571 (2.2); 7.1551 (2.0); 7.1315 (0.6); 7.1280 (0.5); 7.1082 (0.4);
7.1033 (0.6); 7.0919 (0.4); 7.0874 (0.6); 7.0481 (0.3); 6.0652 (1.1); 6.0588 (1.2); 6.0512 (1.2); 6.0448
(1.3); 5.9721 (1.1); 5.9656 (1.3); 5.9581 (1.3); 5.9517 (1.3); 5.6815 (9.6); 5.5137 (3.6); 5.5073 (3.5);
5.2854 (7.6); 5.2837 (7.7); 5.1912 (7.5); 5.1895 (7.7); 4.2745 (0.7); 4.2679 (0.7); 4.2612 (0.7); 4.2546
(0.7); 4.2452 (0.8); 4.2386 (0.8); 4.2319 (0.8); 4.2252 (0.9); 4.2214 (0.9); 4.2148 (0.8); 4.2081 (0.8);
4.2015 (0.8); 4.1920 (0.9); 4.1854 (0.8); 4.1787 (0.9); 4.1722 (0.8); 3.8463 (0.7); 3.8359 (0.8); 3.8323
(0.8); 3.8220 (0.8); 3.8170 (0.7); 3.8065 (0.8); 3.8031 (1.5); 3.7928 (1.5); 3.7896 (0.9); 3.7790 (0.8);
3.7740 (0.8); 3.7637 (0.8); 3.7600 (0.7); 3.7497 (0.6); 2.9552 (0.5); 2.8824 (0.4); 1.5463 (5.0); 1.5031
(0.8); 1.5001 (0.8); 1.4882 (0.4); 1.1045 (0.5); 1.1013 (0.6); 1.0868 (0.6); 1.0838 (0.5); 0.0063
(2.5); −0.0002 (68.0); −0.0068 (2.6)
I-673: ¹H-NMR(499.9 MHz, CDCl3):
δ = 8.1539 (1.6); 7.5772 (1.2); 7.5670 (1.3); 7.4342 (0.7); 7.3779 (0.3); 7.3740 (0.4); 7.3702 (0.4);
7.2596 (8.6); 6.9500 (0.8); 6.8917 (0.6); 6.8886 (0.6); 6.8765 (1.2); 6.8600 (0.4); 5.5303 (1.6); 5.5172
(1.6); 5.2983 (0.5); 2.7317 (5.0); 2.3475 (0.5); 2.2436 (0.4); 2.2310 (4.2); 2.2175 (0.4); 2.1810 (4.2);
1.6361 (0.4); 1.6210 (0.4); 1.6055 (0.4); 1.5607 (1.5); 1.4786 (0.4); 1.4316 (0.8); 1.4222 (0.7); 1.4147
(0.4); 1.3493 (0.4); 1.3360 (0.9); 1.3330 (0.9); 1.2999 (1.4); 1.2924 (1.5); 1.2841 (2.1); 1.2552 (16.0);
1.2224 (2.0); 1.1597 (0.4); 1.1414 (0.3); 1.1334 (0.4); 1.1067 (0.5); 1.0727 (0.4); 0.9951 (0.4); 0.8934
(1.3); 0.8889 (1.1); 0.8802 (2.2); 0.8662 (1.4); 0.8440 (1.7); 0.0695 (6.3); −0.0002 (8.1); −0.0065 (0.4)
I-674: ¹H-NMR(300.2 MHz, CDCl3):
δ = 8.5095 (0.4); 8.4873 (0.6); 8.4659 (0.4); 8.1937 (0.7); 8.1839 (4.8); 7.6291 (2.4); 7.6118 (4.0);
7.5011 (1.8); 7.4424 (0.4); 7.4295 (0.8); 7.4204 (0.8); 7.4153 (1.2); 7.4091 (1.0); 7.3995 (0.7); 7.3909
(0.5); 7.2985 (4.3); 7.2853 (3.9); 7.2780 (1.3); 7.2628 (1.4); 7.2553 (4.6); 7.2441 (0.5); 7.0108 (0.5);
6.9996 (4.4); 6.9921 (1.4); 6.9769 (1.2); 6.9696 (3.6); 6.9582 (0.4); 5.6420 (0.5); 5.6195 (0.5); 5.5789
(4.7); 5.5565 (4.6); 2.7724 (16.0); 1.6288 (1.2); 1.3272 (0.4); 1.2930 (1.8); 0.9377 (0.4); 0.9183 (1.1);
0.8950 (0.5); 0.1083 (0.4); 0.0366 (3.7)
I-675: ¹H-NMR(499.9 MHz, d₆-DMSO):
δ = 9.1740 (1.4); 9.1624 (2.8); 9.1504 (1.4); 8.1040 (16.0); 7.7601 (5.2); 7.5561 (1.3); 7.5531 (1.5);
7.5406 (2.9); 7.5373 (2.3); 7.5350 (2.5); 7.5311 (2.2); 7.5283 (2.0); 7.5251 (1.9); 7.5181 (5.0); 7.5145
(5.2); 7.4998 (8.6); 7.4946 (1.8); 7.4828 (4.8); 7.4660 (1.8); 7.4630 (1.5); 7.3519 (2.4); 7.3356 (4.0);
7.3199 (1.8); 6.0458 (1.0); 6.0375 (1.4); 6.0339 (1.2); 6.0256 (1.0); 5.9535 (1.0); 5.9453 (1.4); 5.9416
(1.2); 5.9334 (1.1); 5.7609 (2.4); 4.6368 (9.9); 3.9214 (0.4); 3.9049 (0.8); 3.8925 (1.4); 3.8804 (1.2);
3.8753 (1.4); 3.8720 (1.2); 3.8633 (1.2); 3.8597 (1.1); 3.8540 (0.6); 3.8469 (1.6); 3.8351 (1.6); 3.8272
(1.0); 3.8244 (1.1); 3.8161 (0.8); 3.8065 (0.3); 3.7981 (0.3); 3.7955 (0.4); 3.3205 (35.1); 2.5151 (4.5);
2.5115 (9.7); 2.5079 (13.6); 2.5042 (9.9); 2.5007 (4.7)
I-676: ¹H-NMR(499.9 MHz, d₆-DMSO):
δ = 9.0925 (1.4); 9.0809 (2.9); 9.0689 (1.5); 8.0075 (16.0); 7.6863 (6.0); 7.4577 (0.8); 7.4540 (0.7);
7.4494 (1.2); 7.4460 (0.9); 7.4410 (1.7); 7.4373 (1.9); 7.4325 (6.0); 7.4290 (7.8); 7.4264 (10.9);
7.4097 (1.7); 7.2815 (0.7); 7.2759 (0.9); 7.2685 (1.4); 7.2617 (2.3); 7.2502 (2.2); 7.2433 (3.8); 7.2361
(5.7); 7.2257 (4.5); 7.2101 (0.5); 7.1783 (1.4); 7.1671 (1.2); 7.1645 (1.0); 7.1592 (0.6); 6.4529 (0.8);
6.4510 (0.9); 6.4221 (0.8); 6.4097 (0.7); 6.3901 (2.0); 6.3778 (0.4); 6.3667 (1.9); 5.9758 (1.0); 5.9674
(1.5); 5.9622 (1.6); 5.9558 (1.2); 5.9476 (2.5); 5.9387 (0.8); 5.9334 (2.4); 5.9245 (2.2); 5.9192 (0.8);
5.9103 (2.2); 5.8961 (0.7); 5.8837 (1.0); 5.8754 (1.5); 5.8722 (1.4); 5.8636 (1.1); 5.6897 (10.5);
3.8505 (0.4); 3.8339 (0.8); 3.8215 (1.5); 3.8172 (1.2); 3.8145 (1.3); 3.8050 (1.8); 3.7946 (1.1); 3.7883
(1.1); 3.7758 (1.7); 3.7665 (1.3); 3.7591 (1.3); 3.7565 (1.3); 3.7478 (0.9); 3.7384 (0.3); 3.7275 (0.3);
3.2513 (24.2); 2.4443 (2.8); 2.4407 (5.9); 2.4371 (8.2); 2.4334 (5.9); 2.4299 (2.7); 1.8430 (2.0);
1.8417 (2.0); 1.8309 (2.1); 1.7420 (7.4); 1.7276 (7.3)
I-677: ¹H-NMR(300.2 MHz, CDCl3):
δ = 8.2943 (16.0); 7.9246 (1.0); 7.9076 (1.5); 7.8885 (1.0); 7.5424 (1.5); 7.5368 (1.8); 7.5218 (1.7);
7.5163 (3.4); 7.5109 (2.2); 7.4960 (1.9); 7.4904 (2.1); 7.4712 (4.5); 7.4425 (8.9); 7.4373 (5.5); 7.4313
(4.2); 7.4233 (1.8); 7.4177 (1.6); 7.3993 (1.7); 7.3953 (3.2); 7.3904 (2.3); 7.3723 (2.4); 7.3666 (2.1);
7.2990 (12.1); 7.2879 (3.5); 7.2839 (6.5); 7.2770 (3.8); 7.2611 (3.7); 7.2567 (5.8); 7.2491 (2.9);
7.2348 (1.6); 7.2305 (1.6); 6.1406 (1.1); 6.1300 (1.2); 6.1181 (1.2); 6.1073 (1.2); 5.9858 (1.1); 5.9752
(1.2); 5.9633 (1.2); 5.9526 (1.2); 4.3346 (0.7); 4.3238 (0.7); 4.3127 (0.7); 4.3018 (0.7); 4.2858 (0.9);
4.2750 (0.9); 4.2639 (0.8); 4.2529 (0.9); 4.2483 (0.9); 4.2373 (0.7); 4.2262 (0.7); 4.2153 (0.7); 4.1993
(0.9); 4.1885 (0.8); 4.1774 (0.9); 4.1665 (0.8); 3.9544 (0.8); 3.9366 (1.0); 3.9319 (1.0); 3.9140 (0.9);
3.9057 (0.7); 3.8877 (0.8); 3.8808 (1.2); 3.8629 (1.3); 3.8579 (1.0); 3.8400 (0.9); 3.8317 (0.8); 3.8138
(0.7); 3.8091 (0.8); 3.7912 (0.6); 3.4190 (9.4); 2.0425 (3.6); 1.5979 (7.7); 0.0485 (0.5); 0.0377 (15.5);
0.0267 (0.5)
I-678: ¹H-NMR(499.9 MHz, d₆-DMSO):
δ = 9.1223 (1.4); 9.1106 (3.0); 9.0989 (1.4); 8.7612 (5.2); 8.7588 (5.1); 8.7465 (4.3); 8.7441 (3.9);
8.7417 (4.2); 8.1158 (16.0); 8.0279 (4.3); 7.7569 (5.8); 7.5324 (1.7); 7.5289 (1.5); 7.5156 (5.5);
7.5121 (5.8); 7.5017 (9.2); 7.4850 (2.7); 7.3599 (2.5); 7.2497 (5.5); 7.1396 (2.7); 6.0466 (1.1); 6.0362
(2.2); 6.0262 (1.1); 5.9543 (1.1); 5.9440 (2.4); 5.9339 (1.1); 5.7612 (2.9); 3.9010 (1.9); 3.8899 (3.2);
3.8790 (1.7); 3.8547 (2.0); 3.8436 (3.3); 3.8327 (1.8); 3.3206 (88.8); 2.5151 (7.4); 2.5116 (15.6);
2.5080 (21.4); 2.5045 (15.4); 2.5010 (7.2)
I-679: ¹H-NMR(400.2 MHz, d₆-DMSO):
δ = 12.0589 (2.7); 9.3335 (1.2); 9.3178 (2.6); 9.3023 (1.2); 7.7485 (1.0); 7.7288 (3.0); 7.7092 (2.9);
7.6889 (3.4); 7.6692 (1.5); 7.6174 (4.0); 7.5772 (2.3); 7.5574 (1.7); 7.3318 (3.5); 7.3118 (3.9); 7.0989
(4.2); 6.9637 (2.2); 6.9443 (2.0); 4.1789 (1.0); 4.1627 (1.0); 4.1411 (2.2); 4.1255 (2.1); 4.1034 (1.1);
4.0875 (1.1); 4.0381 (0.8); 4.0203 (0.8); 3.3268 (20.8); 2.6761 (0.4); 2.6714 (0.5); 2.6670 (0.4);
2.5547 (1.6); 2.5375 (2.8); 2.5250 (2.9); 2.5201 (3.6); 2.5114 (28.6); 2.5070 (58.9); 2.5025 (78.2);
2.4979 (56.3); 2.4935 (27.2); 2.4316 (11.1); 2.3338 (0.4); 2.3292 (0.5); 2.3248 (0.4); 2.2473 (16.0);
2.2225 (4.6); 2.2061 (2.0); 2.0748 (1.5); 1.9890 (3.4); 1.5552 (4.3); 1.5465 (4.8); 1.5381 (4.7); 1.1930
(1.0); 1.1753 (1.9); 1.1575 (1.0); −0.0002 (2.1)
I-680: ¹H-NMR(499.9 MHz, d₆-DMSO):
δ = 9.1982 (1.1); 9.1860 (2.3); 9.1737 (1.1); 8.7591 (4.0); 8.7565 (4.0); 8.7117 (3.4); 8.7094 (3.0);
8.7067 (3.4); 8.0604 (14.6); 7.9985 (3.4); 7.3628 (2.0); 7.3214 (3.7); 7.3055 (4.0); 7.2527 (4.4);
7.1426 (2.2); 7.0747 (4.1); 6.9219 (2.2); 6.9061 (2.0); 5.7611 (1.6); 4.1404 (1.1); 4.1283 (1.2); 4.1110
(2.5); 4.0987 (2.4); 4.0813 (1.2); 4.0691 (1.1); 3.3217 (52.2); 2.5150 (4.4); 2.5115 (8.9); 2.5078
(12.2); 2.5042 (8.8); 2.5006 (4.2); 2.4215 (11.2); 2.2141 (16.0)
I-681: ¹H-NMR(300.2 MHz, CDCl3):
δ = 8.2825 (12.7); 7.8864 (0.8); 7.8689 (1.3); 7.8508 (0.8); 7.5355 (1.2); 7.5299 (1.4); 7.5150 (1.4);
7.5095 (2.8); 7.5041 (1.8); 7.4893 (1.5); 7.4836 (1.6); 7.3959 (1.2); 7.3903 (1.4); 7.3780 (3.8); 7.3681
(2.8); 7.3631 (2.1); 7.3514 (4.2); 7.3455 (2.5); 7.3395 (1.8); 7.2987 (7.0); 7.2741 (2.3); 7.2701 (2.3);
7.2474 (2.8); 7.2438 (3.0); 7.2209 (1.2); 7.2167 (1.3); 7.0646 (3.8); 6.9815 (2.1); 6.9549 (1.8); 4.3032
(2.1); 4.2832 (2.0); 4.2557 (4.3); 4.2358 (4.2); 4.2083 (2.2); 4.1883 (2.1); 3.4149 (7.7); 2.5155 (6.5);
2.5085 (11.8); 2.5011 (6.5); 2.3111 (16.0); 1.6076 (9.0); 0.1107 (1.0); 0.0389 (7.8)
I-682: ¹H-NMR(300.2 MHz, CDCl3):
δ = 8.3079 (7.8); 7.8705 (0.8); 7.6200 (1.9); 7.6152 (3.0); 7.6105 (2.1); 7.4915 (3.3); 7.4856 (5.6);
7.4777 (1.3); 7.4659 (2.5); 7.4625 (2.9); 7.4564 (4.0); 7.4500 (2.7); 7.4154 (4.0); 7.3876 (1.7); 7.2988
(25.5); 6.1238 (0.6); 6.1136 (0.6); 6.0989 (0.7); 6.0890 (0.6); 5.9677 (0.6); 5.9575 (0.7); 5.9426 (0.7);
5.9327 (0.6); 4.3804 (0.4); 4.3703 (0.4); 4.3575 (0.4); 4.3470 (0.4); 4.3319 (0.4); 4.3216 (0.4); 4.3085
(0.4); 4.2985 (0.5); 4.2857 (0.4); 4.2755 (0.4); 4.2627 (0.4); 4.2521 (0.4); 4.2371 (0.5); 4.2267 (0.4);
4.2139 (0.4); 4.2034 (0.4); 3.8595 (0.4); 3.8432 (0.5); 3.8347 (0.4); 3.8182 (0.5); 3.8109 (0.4); 3.7922
(0.6); 3.7859 (0.5); 3.7759 (0.5); 3.7681 (0.6); 3.7504 (0.4); 3.7433 (0.4); 3.7268 (0.4); 3.7180 (0.4);
3.7019 (0.4); 1.7269 (0.3); 1.6292 (0.9); 1.5260 (0.4); 1.4614 (0.8); 1.3714 (0.9); 1.3225 (1.6); 1.2931
(16.0); 1.1409 (0.5); 1.1022 (0.4); 1.0383 (0.9); 1.0160 (0.8); 0.9184 (1.6); 0.8951 (1.2); 0.8643 (1.0);
0.8405 (0.5); 0.0491 (0.7); 0.0382 (29.4); 0.0273 (1.3)
I-683: ¹H-NMR(400.1 MHz, CDCl3):
δ = 7.5496 (0.6); 7.5295 (3.1); 7.5146 (7.5); 7.4379 (4.1); 7.4075 (0.5); 7.3946 (1.6); 7.3880 (2.3);
7.3825 (2.0); 7.3727 (1.9); 7.3523 (3.4); 7.3323 (3.6); 7.2585 (8.3); 7.0533 (4.4); 6.9936 (2.5); 6.9737
(2.2); 6.5571 (1.1); 6.5423 (2.0); 6.5277 (1.2); 4.4407 (0.7); 4.4181 (1.8); 4.3990 (1.6); 4.3755 (1.8);
4.3526 (2.2); 4.3300 (0.9); 4.2287 (1.0); 4.2130 (1.0); 4.1924 (1.8); 4.1767 (1.8); 4.1546 (1.9); 4.1392
(1.7); 4.1187 (1.1); 4.1034 (1.0); 2.4717 (12.1); 2.2970 (16.0); 2.1487 (0.7); 2.1374 (0.6); 2.1296
(0.8); 2.1192 (1.3); 2.1005 (1.3); 2.0899 (0.9); 2.0821 (0.6); 2.0706 (0.8); 1.6653 (0.5); 1.6533 (0.6);
1.6450 (0.7); 1.6362 (1.2); 1.6249 (1.2); 1.6166 (1.2); 1.6051 (1.4); 1.5968 (0.8); 1.5880 (0.7); 1.5759
(0.7); 1.5505 (4.3); 1.3710 (0.6); 1.3611 (0.7); 1.3516 (1.0); 1.3409 (1.3); 1.3285 (1.0); 1.3202 (1.3);
1.3091 (1.1); 1.3000 (0.7); 1.2896 (0.6); 1.2562 (0.6); −0.0002 (7.6)
I-684: ¹H-NMR(400.1 MHz, CDCl3):
δ = 7.5444 (0.6); 7.5244 (3.0); 7.5089 (7.6); 7.4362 (4.1); 7.4062 (0.5); 7.3933 (1.7); 7.3868 (2.3);
7.3812 (1.9); 7.3709 (1.9); 7.3574 (3.5); 7.3373 (3.6); 7.2587 (10.5); 7.0455 (4.4); 6.9806 (2.4);
6.9610 (2.2); 6.5190 (1.0); 6.5041 (1.9); 6.4891 (1.1); 6.0354 (0.4); 6.0213 (0.9); 6.0084 (0.9); 5.9948
(1.3); 5.9790 (1.4); 5.9656 (1.1); 5.9523 (1.2); 5.9383 (0.6); 5.4883 (2.5); 5.4455 (2.2); 5.3691 (2.8);
5.3430 (2.6); 4.8212 (5.7); 4.8073 (5.6); 4.2273 (1.5); 4.2118 (1.6); 4.1901 (3.3); 4.1746 (3.2); 4.1529
(1.8); 4.1374 (1.6); 2.4769 (11.9); 2.3153 (0.6); 2.2904 (16.0); 1.5495 (4.8); 1.2561 (1.0); 0.8445
(0.4); −0.0002 (10.0)
I-685: ¹H-NMR(300.2 MHz, CDCl3):
δ = 12.5375 (0.7); 7.9974 (8.5); 7.5864 (3.8); 7.5600 (0.6); 7.5205 (2.2); 7.4964 (2.9); 7.4681 (1.3);
7.4414 (3.4); 7.4275 (3.2); 7.4018 (2.4); 7.3818 (3.2); 7.3560 (3.5); 7.2991 (9.5); 7.1637 (0.4); 7.1512
(0.4); 7.1267 (2.5); 7.1153 (2.7); 7.1016 (3.0); 7.0693 (5.5); 4.6129 (1.2); 4.5648 (2.4); 4.5173 (1.3);
3.1447 (0.4); 2.9206 (0.4); 2.9063 (0.7); 2.8942 (1.1); 2.8826 (1.6); 2.8702 (1.7); 2.8584 (1.2); 2.8466
(0.7); 2.5304 (1.0); 2.5009 (11.0); 2.4262 (0.3); 2.4015 (0.5); 2.3668 (16.0); 2.3199 (0.6); 1.7102
(0.3); 1.4595 (0.4); 1.3693 (0.5); 1.3212 (0.8); 1.2922 (1.6); 0.9217 (1.1); 0.8983 (4.4); 0.8791 (4.4);
0.8568 (1.6); 0.8278 (0.4); 0.6624 (1.3); 0.6390 (3.9); 0.6330 (3.6); 0.6090 (1.0); 0.0471 (0.4); 0.0363
(9.7); 0.0258 (0.5)
I-686: ¹H-NMR(499.9 MHz, CDCl3):
δ = 8.2537 (10.6); 7.9221 (0.9); 7.9115 (1.5); 7.9007 (0.8); 7.3418 (3.7); 7.3258 (4.0); 7.2774 (1.0);
7.2733 (1.3); 7.2596 (15.3); 7.2490 (5.2); 7.2443 (2.4); 7.2342 (4.1); 7.2180 (1.6); 7.1956 (1.8);
7.1917 (1.6); 7.1830 (1.7); 7.1804 (1.5); 7.1773 (1.8); 7.1696 (1.0); 7.1640 (0.8); 7.0345 (3.9); 6.9494
(2.2); 6.9335 (1.9); 5.2978 (0.4); 4.2480 (1.2); 4.2421 (1.2); 4.2361 (1.2); 4.2302 (1.2); 4.2193 (2.2);
4.2132 (2.2); 4.2074 (2.1); 4.2013 (2.0); 4.1904 (1.2); 4.1844 (1.3); 4.1784 (1.1); 4.1726 (1.2); 4.1585
(2.2); 4.1531 (2.7); 4.1456 (2.0); 3.2218 (2.9); 3.2135 (3.0); 3.2107 (3.1); 3.2024 (2.8); 2.8450 (3.0);
2.8400 (3.0); 2.8338 (2.8); 2.8288 (2.7); 2.4769 (11.4); 2.2801 (16.0); 1.5477 (11.6); 0.0060
(1.1); −0.0002 (16.1); −0.0067 (0.5)
I-687: ¹H-NMR(300.2 MHz, CDCl3):
δ = 7.5896 (0.6); 7.5634 (3.2); 7.5423 (9.3); 7.5250 (0.8); 7.4674 (4.3); 7.4503 (0.6); 7.4329 (1.9);
7.4235 (2.9); 7.4161 (2.2); 7.4056 (4.9); 7.3797 (4.2); 7.2992 (21.5); 7.1133 (1.0); 7.0807 (4.9);
7.0230 (2.4); 6.9960 (2.1); 6.5335 (0.5); 5.3379 (0.5); 4.5686 (4.2); 4.5599 (3.2); 4.5543 (4.6); 4.5481
(3.3); 4.5398 (4.5); 4.4309 (0.8); 4.4077 (2.2); 4.3844 (2.3); 4.3611 (0.8); 4.2787 (0.6); 4.2642 (1.8);
4.2435 (1.7); 4.2286 (1.3); 4.2145 (3.8); 4.1937 (3.6); 4.1788 (0.8); 4.1657 (2.5); 4.1436 (2.7); 4.1195
(0.4); 3.8071 (4.5); 3.7988 (3.3); 3.7925 (4.6); 3.7869 (3.4); 3.7782 (4.3); 3.6217 (2.5); 3.5984 (7.7);
3.5751 (7.8); 3.5518 (2.6); 2.5224 (13.2); 2.5159 (10.0); 2.3750 (0.4); 2.3354 (5.0); 2.3148 (15.3);
2.0810 (4.4); 1.6136 (9.0); 1.4922 (2.3); 1.4689 (4.7); 1.4456 (2.3); 1.3199 (1.3); 1.2959 (2.8); 1.2722
(1.3); 1.2292 (8.0); 1.2059 (16.0); 1.1825 (7.7); 0.1085 (0.6); 0.0490 (0.6); 0.0381 (17.4); 0.0274 (0.7)
I-688: ¹H-NMR(300.2 MHz, CDCl3):
δ = 7.6091 (0.4); 7.5823 (3.2); 7.5786 (3.2); 7.5733 (3.0); 7.5651 (6.9); 7.5621 (7.7); 7.4769 (3.7);
7.4546 (0.5); 7.4401 (1.6); 7.4278 (2.1); 7.4210 (2.0); 7.4102 (1.6); 7.3935 (3.7); 7.3667 (4.1); 7.2990
(16.0); 7.1021 (4.1); 7.0394 (2.2); 7.0129 (1.9); 6.7150 (1.0); 6.6941 (1.9); 6.6737 (1.0); 6.4974 (0.4);
6.4910 (0.7); 6.4843 (1.0); 6.4777 (1.0); 6.4712 (0.7); 6.4646 (0.4); 6.4449 (0.7); 6.4385 (1.0); 6.4319
(1.4); 6.4251 (1.4); 6.4186 (1.0); 6.4120 (0.6); 6.2320 (0.4); 6.2178 (0.6); 6.2113 (1.2); 6.2047 (0.7);
6.1972 (0.7); 6.1904 (1.2); 6.1838 (0.8); 6.1694 (0.6); 6.1589 (0.8); 6.1522 (0.5); 6.1446 (0.4); 6.1378
(0.8); 6.1314 (0.4); 4.9230 (0.8); 4.9146 (2.6); 4.9062 (4.0); 4.8993 (4.0); 4.8940 (3.9); 4.8856 (2.5);
4.8768 (0.8); 4.2853 (1.7); 4.2644 (1.6); 4.2358 (3.5); 4.2147 (3.4); 4.1860 (1.8); 4.1650 (1.8); 2.5172
(11.8); 2.3478 (16.0); 1.6035 (12.6); 0.0494 (0.5); 0.0385 (14.8); 0.0276 (0.6)
I-689: ¹H-NMR(300.2 MHz, CDCl3):
δ = 7.6272 (1.4); 7.6097 (1.9); 7.5080 (0.9); 7.4524 (0.4); 7.4438 (0.4); 7.4370 (0.5); 7.4307 (0.5);
7.2990 (18.0); 7.2384 (11.6); 4.1937 (0.9); 4.1705 (1.9); 4.1480 (1.1); 3.1693 (0.8); 3.1483 (1.2);
3.1434 (1.2); 3.1267 (0.5); 3.1194 (0.5); 2.2299 (8.0); 1.5857 (16.0); 1.3041 (0.5); 0.9201 (0.5);
0.1072 (1.5); 0.0487 (0.6); 0.0379 (19.5); 0.0270 (0.8)
I-690: ¹H-NMR(300.2 MHz, CDCl3):
δ = 8.6582 (2.0); 8.6544 (2.1); 8.5940 (1.9); 8.5858 (1.8); 7.7669 (1.7); 7.3935 (1.9); 7.3668 (2.2);
7.2989 (6.9); 7.0993 (2.2); 7.0343 (1.2); 7.0081 (1.0); 6.9628 (1.2); 6.7774 (2.4); 6.7603 (0.5); 6.7391
(1.0); 6.7186 (0.5); 6.5921 (1.2); 4.2916 (0.9); 4.2708 (0.9); 4.2425 (2.0); 4.2217 (1.9); 4.1933 (1.0);
4.1725 (1.0); 2.5285 (6.3); 2.3985 (16.0); 2.3608 (2.0); 2.3427 (8.5); 1.6419 (1.0); 0.0370 (8.2)
I-691: ¹H-NMR(300.2 MHz, CDCl3):
δ = 8.5678 (0.6); 8.1513 (5.1); 7.6233 (1.5); 7.6173 (1.3); 7.6125 (1.3); 7.6053 (3.6); 7.6021 (3.8);
7.5046 (1.8); 7.4665 (0.7); 7.4549 (1.0); 7.4483 (0.9); 7.4363 (0.7); 7.4282 (0.4); 7.2988 (2.7); 7.1752
(2.9); 7.0357 (3.1); 4.3377 (1.8); 4.3250 (1.6); 4.3203 (2.2); 4.3133 (1.6); 4.3019 (2.2); 4.0210 (1.1);
4.0096 (0.9); 4.0027 (2.2); 3.9913 (1.1); 3.9848 (2.0); 3.9668 (0.9); 2.8347 (0.6); 2.7507 (16.0);
2.0380 (0.5); 1.9595 (11.8); 1.8550 (0.8); 0.1052 (0.6); 0.0330 (2.7)
I-692: ¹H-NMR(300.2 MHz, CDCl3):
δ = 7.4600 (0.5); 7.4487 (0.5); 7.4387 (1.0); 7.4274 (1.1); 7.4168 (0.5); 7.4060 (0.6); 7.3827 (1.7);
7.3561 (2.0); 7.2988 (4.5); 7.1927 (2.8); 7.1884 (1.7); 7.1819 (1.5); 7.1786 (1.6); 7.1673 (2.6); 7.0769
(1.9); 6.9780 (1.0); 6.9511 (0.9); 6.9039 (1.0); 6.8665 (1.0); 6.8448 (1.1); 6.8074 (1.1); 6.5167 (0.4);
6.4959 (0.8); 6.4752 (0.4); 5.9049 (1.8); 5.9023 (1.8); 5.8459 (1.6); 5.8433 (1.6); 5.4788 (1.8); 5.4763
(1.8); 5.4415 (1.6); 5.4389 (1.7); 4.2890 (0.9); 4.2680 (0.9); 4.2411 (1.9); 4.2200 (1.8); 4.1931 (1.0);
4.1720 (0.9); 2.5285 (5.8); 2.5219 (3.3); 2.3769 (16.0); 2.3205 (7.8); 1.6276 (0.7); 0.0384 (4.5)
I-693: ¹H-NMR(400.1 MHz, d₆-DMSO):
δ = 8.8691 (0.7); 8.8549 (1.4); 8.8406 (0.7); 7.9625 (0.9); 7.5001 (0.7); 7.4793 (1.4); 7.4587 (0.9);
7.1428 (3.7); 7.1348 (4.1); 7.0529 (1.8); 7.0338 (2.1); 6.9450 (2.6); 6.8325 (1.5); 6.8135 (1.2); 3.5181
(0.9); 3.5016 (2.1); 3.4850 (2.1); 3.4687 (0.9); 3.3123 (14.1); 2.9001 (4.6); 2.8048 (1.6); 2.7871 (3.0);
2.7694 (1.4); 2.7413 (4.4); 2.5101 (8.2); 2.2591 (16.0); 2.1998 (10.3); 1.5603 (0.5); 1.5416 (1.7);
1.5242 (0.6); 1.5117 (0.5); 1.4934 (1.7); 1.4757 (0.6); 1.2196 (0.6); 1.1990 (2.1); 1.1809 (2.0); 1.1596 (0.4)
I-694: ¹H-NMR(400.1 MHz, d₆-DMSO):
δ = 8.8749 (0.9); 8.8607 (1.7); 8.8465 (0.8); 7.9622 (0.8); 7.4582 (0.9); 7.4384 (1.9); 7.4171 (1.2);
7.2123 (2.0); 7.1929 (1.7); 7.1188 (5.4); 7.1021 (1.7); 7.0546 (2.1); 7.0355 (2.5); 6.9485 (3.1); 6.8385
(1.7); 6.8200 (1.4); 3.5129 (1.0); 3.4960 (2.4); 3.4796 (2.4); 3.4629 (1.0); 3.3125 (20.4); 3.1136 (0.5);
3.0929 (0.6); 3.0833 (0.9); 3.0609 (0.9); 3.0305 (0.5); 2.9001 (4.6); 2.8035 (1.9); 2.7857 (3.4); 2.7679
(1.7); 2.7413 (4.4); 2.5099 (10.4); 2.2622 (15.5); 2.2565 (16.0); 2.2025 (12.2); 2.0638 (0.4); 2.0441
(0.6); 2.0296 (0.6); 2.0135 (1.0); 1.9984 (1.1); 1.9836 (1.2); 1.9709 (1.3); 1.9624 (0.7); 1.9503 (0.8);
1.9398 (0.6)
I-695: ¹H-NMR(400.1 MHz, d₆-DMSO):
δ = 9.3120 (1.0); 9.2967 (2.1); 9.2810 (1.0); 7.9623 (1.6); 7.4567 (1.2); 7.4360 (2.3); 7.4152 (1.6);
7.3407 (2.6); 7.3207 (2.9); 7.2117 (2.4); 7.1924 (2.0); 7.1115 (8.5); 7.0956 (2.4); 7.0092 (2.0); 6.9896
(1.8); 4.1588 (0.9); 4.1437 (1.0); 4.1213 (2.0); 4.1059 (1.9); 4.0837 (1.1); 4.0680 (0.9); 3.3123 (28.2);
3.1148 (0.6); 3.0926 (0.8); 3.0832 (1.1); 3.0618 (1.1); 3.0525 (0.8); 3.0307 (0.7); 2.9001 (8.7); 2.7413
(8.1); 2.5101 (13.6); 2.4424 (9.5); 2.2632 (12.7); 2.1950 (16.0); 2.0440 (0.6); 2.0306 (0.8); 2.0140
(1.1); 1.9982 (1.3); 1.9867 (1.1); 1.9768 (1.0); 1.9661 (1.5); 1.9546 (0.8); 1.9438 (0.9); 1.9330 (0.8);
1.9236 (0.3)
I-696: ¹H-NMR(400.1 MHz, d₆-DMSO):
δ = 9.1849 (1.4); 9.1700 (2.6); 9.1557 (1.3); 7.9623 (2.6); 7.6621 (4.4); 7.5590 (2.1); 7.5530 (2.3);
7.5380 (2.7); 7.5320 (2.8); 7.4599 (1.5); 7.4408 (3.3); 7.4201 (2.1); 7.3963 (1.7); 7.3826 (2.1); 7.3669
(1.3); 7.2172 (3.3); 7.1981 (2.7); 7.1149 (9.4); 7.0971 (2.7); 6.0529 (0.9); 6.0403 (1.7); 6.0283 (0.9);
5.9364 (0.9); 5.9251 (1.8); 5.9134 (0.9); 3.9351 (1.5); 3.9226 (2.5); 3.9093 (1.6); 3.8748 (1.5); 3.8630
(2.5); 3.8497 (1.5); 3.3118 (43.7); 3.1165 (0.8); 3.0955 (1.1); 3.0859 (1.5); 3.0643 (1.6); 3.0333 (0.9);
2.9001 (14.2); 2.7412 (13.3); 2.5099 (20.7); 2.2518 (16.0); 2.0659 (0.4); 2.0454 (0.8); 2.0320 (1.0);
2.0153 (1.6); 2.0010 (1.9); 1.9908 (1.5); 1.9831 (1.6); 1.9697 (2.3); 1.9598 (1.2); 1.9483 (1.3); 1.9375
(1.1); 1.9177 (0.3)
I-697: ¹H-NMR(300.2 MHz, CDCl3):
δ = 7.5955 (0.4); 7.5793 (0.5); 7.3835 (0.5); 7.3559 (0.5); 7.3037 (7.4); 7.2204 (0.8); 7.0712 (0.5);
7.0436 (0.4); 6.2394 (0.5); 3.0793 (0.3); 2.0884 (0.8); 1.6162 (0.4); 1.4653 (0.4); 1.3730 (0.7); 1.3260
(1.9); 1.2979 (16.0); 1.1958 (0.6); 1.1699 (0.5); 1.1454 (0.7); 1.0889 (0.4); 0.9233 (1.6); 0.8982 (1.8);
0.8744 (1.3); 0.7569 (0.4); 0.0427 (6.8)
I-698: ¹H-NMR(499.9 MHz, CDCl3):
δ = 8.2690 (0.6); 8.2633 (11.7); 7.9122 (1.1); 7.9032 (1.0); 7.5516 (3.6); 7.3767 (0.7); 7.3574 (10.4);
7.3408 (0.6); 7.2970 (0.6); 7.2930 (0.7); 7.2894 (0.6); 7.2850 (0.9); 7.2808 (1.4); 7.2771 (1.4); 7.2733
(1.6); 7.2687 (2.4); 7.2611 (13.1); 7.2563 (1.6); 7.2483 (3.7); 7.2322 (1.4); 7.2046 (1.6); 7.2008 (1.6);
7.1920 (1.6); 7.1891 (1.4); 7.1863 (1.6); 7.1785 (0.9); 7.1730 (0.8); 6.0574 (1.0); 6.0509 (1.1); 6.0439
(1.1); 6.0374 (1.0); 5.9645 (1.0); 5.9580 (1.1); 5.9510 (1.1); 5.9445 (1.0); 5.2983 (16.0); 4.2748 (0.3);
4.2702 (0.4); 4.2685 (0.4); 4.2637 (0.4); 4.2618 (0.4); 4.2571 (0.4); 4.2553 (0.4); 4.2507 (0.4); 4.2454
(0.4); 4.2409 (0.5); 4.2392 (0.5); 4.2343 (0.5); 4.2325 (0.5); 4.2277 (0.5); 4.2259 (0.6); 4.2217 (0.6);
4.2187 (0.5); 4.2120 (0.4); 4.2100 (0.5); 4.2054 (0.5); 4.2036 (0.5); 4.1989 (0.4); 4.1937 (0.5); 4.1892
(0.5); 4.1874 (0.5); 4.1826 (0.5); 4.1807 (0.6); 4.1759 (0.5); 4.1742 (0.6); 4.1695 (0.5); 4.1631 (2.0);
4.1577 (2.4); 4.1555 (2.4); 4.1502 (2.1); 3.8831 (0.5); 3.8723 (0.6); 3.8699 (0.6); 3.8590 (0.6); 3.8538
(0.5); 3.8396 (0.9); 3.8289 (0.9); 3.8141 (0.6); 3.8092 (0.5); 3.7979 (0.6); 3.7849 (0.4); 3.2235 (2.7);
3.2153 (2.8); 3.2124 (3.2); 3.2041 (2.9); 2.8493 (1.9); 2.8479 (2.1); 2.8444 (2.1); 2.8429 (2.2); 2.8382
(2.0); 2.8367 (2.1); 2.8332 (2.0); 2.8317 (2.1); 2.1690 (0.4); 2.0039 (0.6); 1.5574 (3.6); 0.0063
(0.4); −0.0002 (13.2); −0.0067 (0.8)
I-699: ¹H-NMR(499.9 MHz, CDCl3):
δ = 8.2424 (10.1); 8.0626 (1.0); 8.0518 (1.6); 8.0410 (0.9); 7.3970 (2.1); 7.3811 (4.2); 7.3652 (2.5);
7.3216 (3.5); 7.3056 (3.7); 7.2563 (3.1); 7.0529 (2.4); 7.0483 (2.6); 7.0370 (5.9); 7.0129 (2.7); 6.9974
(2.4); 6.9460 (2.3); 6.9301 (2.1); 6.9011 (3.0); 6.8977 (4.0); 4.7299 (0.8); 4.7243 (1.1); 4.7197 (0.9);
4.7177 (1.0); 4.7119 (1.0); 4.7075 (0.7); 4.6027 (0.8); 4.5971 (1.1); 4.5925 (0.9); 4.5905 (1.0); 4.5847
(1.0); 4.5803 (0.7); 4.2249 (1.7); 4.2130 (1.6); 4.1959 (3.5); 4.1841 (3.4); 4.1669 (1.8); 4.1550 (1.6);
2.4701 (12.0); 2.4439 (1.1); 2.4302 (0.7); 2.4263 (0.7); 2.4222 (0.7); 2.4184 (0.7); 2.4077 (0.6);
2.4041 (0.6); 2.2937 (16.0); 1.6066 (0.7); 1.6007 (0.8); 1.5919 (0.9); 1.5844 (1.3); 1.5781 (1.3);
1.5694 (0.9); 1.5621 (1.1); 1.5557 (0.7); 1.5469 (0.8); 1.5396 (1.0); 1.5332 (0.7); 1.5244 (0.7); 1.5185
(0.6); 1.1587 (0.7); 1.1444 (1.5); 1.1378 (0.9); 1.1316 (1.5); 1.1235 (1.6); 1.1172 (0.8); 1.1107 (1.4);
1.0963 (0.6); −0.0002 (3.6)
I-700: ¹H-NMR(499.9 MHz, CDCl3):
δ = 8.2451 (11.8); 8.1682 (0.5); 8.0935 (1.0); 8.0828 (1.5); 8.0721 (0.9); 7.4200 (2.2); 7.4041 (4.7);
7.3882 (2.8); 7.3249 (3.6); 7.3089 (3.8); 7.2573 (6.8); 7.2513 (2.8); 7.2351 (2.2); 7.1177 (3.9); 7.0717
(2.4); 7.0684 (2.0); 7.0672 (1.9); 7.0567 (2.0); 7.0555 (2.1); 7.0522 (1.9); 7.0508 (1.8); 7.0253 (4.0);
6.9354 (2.2); 6.9195 (1.9); 5.2937 (0.4); 4.8964 (0.8); 4.8904 (0.8); 4.8843 (1.3); 4.8782 (1.3); 4.8721
(0.8); 4.8661 (0.7); 4.7650 (0.8); 4.7585 (0.8); 4.7531 (1.2); 4.7466 (1.2); 4.7409 (0.8); 4.7346 (0.7);
4.2246 (1.4); 4.2127 (1.4); 4.1972 (2.6); 4.1954 (2.6); 4.1853 (2.5); 4.1834 (2.5); 4.1667 (1.4); 4.1547
(1.3); 2.4685 (11.4); 2.3227 (0.8); 2.2785 (16.0); 2.1437 (0.5); 2.1315 (1.0); 2.1227 (0.8); 2.1196
(0.8); 2.1155 (1.2); 2.1115 (1.2); 2.1040 (0.7); 2.0990 (0.7); 2.0954 (1.0); 2.0833 (0.5); 1.5687 (0.5);
1.3435 (0.5); 1.3374 (0.6); 1.3281 (1.4); 1.3221 (1.4); 1.3124 (1.1); 1.3061 (1.3); 1.3048 (1.4); 1.2999
(0.6); 1.2928 (1.5); 1.2894 (1.0); 1.2842 (2.4); 1.2778 (3.0); 1.2721 (1.4); 1.2685 (2.0); 1.2666 (1.8);
1.2622 (1.6); 1.2573 (1.8); 1.2512 (0.6); 1.2459 (1.1); 1.2424 (0.5); 1.2403 (0.4); 1.2307 (0.4); 0.0062
(0.5); −0.0002 (7.5)
I-701: ¹H-NMR(499.9 MHz, CDCl3):
δ = 8.2623 (16.0); 8.2541 (0.3); 7.9194 (1.6); 7.9095 (1.5); 7.4290 (5.6); 7.4122 (6.7); 7.4039 (3.2);
7.4014 (5.3); 7.3998 (5.2); 7.3979 (5.4); 7.3240 (0.4); 7.3087 (0.5); 7.2987 (1.0); 7.2950 (1.4); 7.2917
(1.3); 7.2873 (1.4); 7.2859 (1.4); 7.2826 (2.2); 7.2791 (2.3); 7.2755 (2.4); 7.2699 (2.9); 7.2613 (18.1);
7.2460 (5.4); 7.2298 (2.8); 7.2226 (3.5); 7.2210 (3.4); 7.2032 (4.6); 7.1903 (2.5); 7.1864 (2.6); 7.1761
(1.4); 7.1714 (1.2); 6.0717 (1.3); 6.0653 (1.5); 6.0581 (1.4); 6.0517 (1.4); 5.9788 (1.3); 5.9724 (1.4);
5.9652 (1.4); 5.9588 (1.3); 4.2724 (0.6); 4.2685 (0.6); 4.2661 (0.7); 4.2620 (0.6); 4.2594 (0.7); 4.2554
(0.7); 4.2529 (0.7); 4.2489 (0.6); 4.2431 (0.7); 4.2392 (0.8); 4.2368 (0.8); 4.2326 (0.8); 4.2301 (0.8);
4.2260 (0.8); 4.2235 (0.9); 4.2200 (1.1); 4.2168 (0.8); 4.2141 (0.8); 4.2101 (0.7); 4.2074 (0.8); 4.2034
(0.8); 4.2009 (0.8); 4.1969 (0.7); 4.1911 (0.8); 4.1872 (0.9); 4.1847 (0.9); 4.1807 (0.9); 4.1780 (0.9);
4.1740 (1.0); 4.1715 (1.0); 4.1676 (0.9); 4.1595 (3.0); 4.1541 (3.5); 4.1522 (3.5); 4.1466 (2.8); 3.8861
(0.9); 3.8753 (1.0); 3.8728 (1.0); 3.8619 (1.0); 3.8568 (0.9); 3.8426 (1.5); 3.8319 (1.5); 3.8173 (0.9);
3.8123 (0.9); 3.8010 (0.9); 3.7881 (0.6); 3.2223 (4.1); 3.2142 (4.2); 3.2112 (4.5); 3.2030 (4.1); 2.8460
(3.6); 2.8410 (3.6); 2.8348 (3.4); 2.8299 (3.1); 2.0036 (7.3); 1.5730 (0.5); 0.0708 (0.5); 0.0063
(0.9); −0.0002 (16.8); −0.0068 (0.6)
I-702: ¹H-NMR(300.2 MHz, CDCl3):
δ = 7.3851 (2.8); 7.3587 (3.4); 7.2984 (13.8); 7.2378 (0.6); 7.2188 (1.0); 7.2006 (0.6); 7.0851 (0.6);
7.0698 (4.8); 7.0579 (7.2); 7.0551 (7.2); 7.0494 (6.4); 7.0283 (0.7); 6.9841 (2.5); 6.9581 (2.2); 6.8011
(0.7); 6.7958 (1.0); 6.7816 (1.4); 6.7741 (1.6); 6.7633 (1.4); 6.7530 (0.8); 6.7425 (0.6); 5.2470 (0.5);
5.2309 (1.7); 5.2148 (1.7); 5.1987 (0.5); 5.0947 (0.7); 5.0787 (2.1); 5.0627 (2.1); 5.0468 (0.6); 4.3681
(0.7); 4.3543 (0.7); 4.3458 (0.9); 4.3321 (0.9); 4.3232 (1.0); 4.3099 (1.0); 4.2970 (0.8); 4.2849 (0.8);
4.2681 (0.4); 4.2550 (1.1); 4.2465 (1.0); 4.2332 (2.2); 4.2197 (0.8); 4.2050 (3.3); 4.1844 (2.9); 4.1708
(1.2); 4.1563 (1.2); 4.1474 (0.8); 4.1360 (1.2); 4.1275 (0.6); 4.1214 (0.6); 3.9999 (1.2); 3.9713 (1.9);
3.9472 (1.5); 3.8567 (1.6); 3.8412 (1.5); 3.8282 (1.1); 3.8126 (1.0); 3.6642 (0.5); 3.6461 (1.7); 3.6349
(0.8); 3.6227 (1.7); 3.6176 (1.7); 3.6035 (1.8); 3.5941 (1.6); 3.5833 (1.1); 3.5732 (1.1); 3.5696 (1.0);
3.5575 (0.9); 3.5509 (0.8); 3.5343 (0.8); 3.4834 (0.7); 3.4652 (1.3); 3.4469 (0.7); 3.4396 (0.6); 3.4212
(0.9); 3.4028 (0.4); 2.6244 (12.2); 2.6034 (14.7); 2.5056 (11.7); 2.3225 (16.0); 2.2901 (0.4); 2.1537
(0.4); 2.1356 (0.9); 2.1243 (1.0); 2.1078 (1.8); 2.0905 (1.1); 2.0822 (1.3); 2.0621 (0.5); 1.6304 (10.3);
1.4748 (8.6); 1.4588 (8.5); 1.4306 (7.1); 1.4145 (7.0); 1.2964 (0.4); 1.0541 (0.9); 1.0384 (3.2); 1.0320
(3.2); 1.0096 (3.2); 1.0045 (3.0); 0.9911 (1.2); 0.8029 (1.4); 0.7868 (4.1); 0.7836 (4.1); 0.7712 (3.6);
0.7653 (4.1); 0.7492 (1.1); 0.1076 (0.9); 0.0480 (0.6); 0.0372 (15.4); 0.0264 (0.6)
I-703: ¹H-NMR(499.9 MHz, CDCl3):
δ = 7.4223 (2.3); 7.4056 (2.7); 7.3905 (2.9); 7.2599 (7.7); 7.1846 (1.6); 7.1812 (1.7); 7.1679 (1.4);
7.1645 (1.5); 7.0956 (0.6); 7.0793 (2.0); 7.0648 (3.5); 7.0523 (1.6); 7.0393 (0.5); 6.8187 (0.7); 6.8133
(0.7); 6.8051 (1.4); 6.8015 (1.3); 6.7897 (0.8); 6.7871 (0.8); 6.4753 (0.7); 6.4637 (1.2); 6.4522 (0.7);
6.0293 (0.6); 6.0230 (0.7); 6.0166 (0.7); 6.0102 (0.6); 5.9367 (0.6); 5.9304 (0.7); 5.9239 (0.7); 5.9176
(0.6); 4.1884 (0.3); 4.1820 (0.3); 4.1755 (0.3); 4.1655 (0.4); 4.1590 (0.4); 4.1526 (0.4); 4.1454 (0.6);
4.1383 (0.4); 4.1319 (0.4); 4.1252 (0.3); 4.1153 (0.4); 4.1088 (0.4); 4.1024 (0.4); 4.0959 (0.4); 3.9534
(0.4); 3.9409 (0.6); 3.9283 (0.4); 3.9244 (0.4); 3.9111 (0.6); 3.9077 (0.5); 3.8949 (0.7); 3.8820 (0.4);
3.8781 (0.4); 3.8652 (0.5); 2.4102 (16.0); 2.0857 (0.6); 2.0788 (0.7); 2.0688 (1.2); 2.0588 (0.8);
2.0521 (0.7); 2.0416 (0.4); 1.5509 (5.2); 1.0277 (0.7); 1.0180 (2.2); 1.0148 (2.5); 1.0013 (2.4); 0.9980
(2.5); 0.9888 (1.0); 0.7745 (0.8); 0.7626 (3.0); 0.7521 (3.1); 0.7422 (0.9); −0.0002 (9.3)
I-704: ¹H-NMR(499.9 MHz, CDCl3):
δ = 7.4216 (2.6); 7.4048 (2.9); 7.3897 (3.1); 7.2600 (7.3); 7.1840 (1.8); 7.1806 (1.9); 7.1672 (1.5);
7.1639 (1.6); 7.0947 (0.8); 7.0784 (2.2); 7.0640 (3.6); 7.0515 (1.6); 7.0386 (0.5); 6.8178 (0.8); 6.8126
(0.9); 6.8043 (1.5); 6.8010 (1.4); 6.7864 (0.8); 6.4854 (0.8); 6.4739 (1.3); 6.4623 (0.7); 6.0282 (0.7);
6.0219 (0.7); 6.0154 (0.7); 6.0091 (0.6); 5.9356 (0.7); 5.9293 (0.7); 5.9229 (0.7); 5.9165 (0.6); 4.1927
(0.4); 4.1862 (0.4); 4.1800 (0.4); 4.1733 (0.4); 4.1634 (0.5); 4.1569 (0.5); 4.1505 (0.5); 4.1432 (0.7);
4.1362 (0.4); 4.1298 (0.4); 4.1231 (0.4); 4.1132 (0.4); 4.1066 (0.4); 4.1004 (0.4); 4.0938 (0.4); 3.9523
(0.4); 3.9397 (0.7); 3.9273 (0.5); 3.9234 (0.4); 3.9100 (0.6); 3.9068 (0.6); 3.8938 (0.8); 3.8810 (0.4);
3.8772 (0.4); 3.8640 (0.5); 2.4086 (16.0); 2.0955 (0.4); 2.0849 (0.7); 2.0779 (0.8); 2.0681 (1.3);
2.0581 (0.8); 2.0514 (0.7); 2.0408 (0.3); 1.5545 (4.5); 1.0273 (1.0); 1.0176 (2.5); 1.0145 (2.8); 1.0009
(2.5); 0.9976 (2.6); 0.9884 (0.9); 0.7740 (1.2); 0.7620 (3.3); 0.7516 (3.2); 0.7417 (0.8); −0.0002 (8.0)
I-705: ¹H-NMR(499.9 MHz, CDCl3):
δ = 8.0436 (16.0); 7.9953 (1.3); 7.9845 (2.0); 7.9737 (1.3); 7.6229 (1.2); 7.6073 (4.0); 7.5918 (8.6);
7.5750 (1.2); 7.5437 (6.8); 7.4813 (5.2); 7.4139 (2.1); 7.4100 (3.5); 7.4060 (2.2); 7.3955 (2.6); 7.3734
(1.8); 7.3700 (1.6); 7.3566 (6.6); 7.3533 (6.8); 7.3453 (10.0); 7.3286 (2.4); 7.2606 (13.7); 6.0505
(1.4); 6.0441 (1.6); 6.0364 (1.6); 6.0299 (1.4); 5.9573 (1.4); 5.9508 (1.6); 5.9431 (1.6); 5.9366 (1.4);
4.2788 (0.8); 4.2722 (0.8); 4.2654 (0.8); 4.2588 (0.8); 4.2495 (0.9); 4.2429 (1.0); 4.2361 (0.9); 4.2295
(1.0); 4.2249 (0.9); 4.2183 (0.8); 4.2114 (0.9); 4.2049 (0.8); 4.1955 (1.0); 4.1889 (0.9); 4.1822 (0.9);
4.1756 (0.8); 3.8351 (0.9); 3.8247 (1.0); 3.8209 (0.9); 3.8105 (1.0); 3.8058 (0.9); 3.7921 (1.6); 3.7817
(1.6); 3.7680 (0.9); 3.7633 (0.9); 3.7529 (0.8); 3.7491 (0.8); 3.7388 (0.7); 2.2373 (0.8); 2.2271 (1.7);
2.2213 (1.8); 2.2161 (1.3); 2.2113 (3.3); 2.2043 (1.3); 2.2009 (1.8); 2.1951 (1.8); 2.1848 (0.9); 1.5590
(3.4); 1.2846 (0.4); 1.2558 (0.7); 1.1770 (0.9); 1.1644 (3.5); 1.1590 (7.0); 1.1550 (6.8); 1.1495 (6.1);
1.1455 (7.2); 1.1421 (7.6); 1.1366 (3.5); 1.1300 (4.0); 1.1251 (5.4); 1.1201 (3.3); 1.1081 (0.9); 0.8456
(0.4); 0.8394 (0.4); 0.0060 (0.8); −0.0002 (16.2); −0.0067 (0.7)
I-706: ¹H-NMR(499.9 MHz, CDCl3):
δ = 8.0436 (16.0); 7.9848 (2.8); 7.6231 (1.4); 7.6076 (4.6); 7.5923 (10.4); 7.5779 (2.0); 7.5755 (2.0);
7.5438 (8.2); 7.4816 (6.5); 7.4379 (0.4); 7.4285 (0.5); 7.4136 (3.0); 7.4100 (4.2); 7.4061 (2.8); 7.3956
(3.4); 7.3734 (2.4); 7.3702 (2.0); 7.3567 (8.3); 7.3534 (7.6); 7.3455 (11.0); 7.3288 (3.0); 7.2607
(13.2); 6.0507 (1.6); 6.0442 (1.8); 6.0365 (1.8); 6.0301 (1.7); 5.9573 (1.6); 5.9509 (1.8); 5.9432 (1.9);
5.9369 (1.7); 4.2788 (0.9); 4.2723 (1.0); 4.2655 (1.0); 4.2589 (1.0); 4.2495 (1.1); 4.2430 (1.1); 4.2362
(1.1); 4.2295 (1.2); 4.2250 (1.1); 4.2184 (1.0); 4.2115 (1.1); 4.2050 (1.0); 4.1956 (1.1); 4.1890 (1.1);
4.1822 (1.1); 4.1757 (1.0); 3.8352 (0.9); 3.8247 (1.2); 3.8212 (1.1); 3.8106 (1.2); 3.8061 (1.0); 3.7924
(1.9); 3.7819 (2.0); 3.7680 (1.2); 3.7635 (1.1); 3.7529 (1.2); 3.7494 (1.0); 3.7390 (0.9); 2.2374 (0.9);
2.2272 (1.9); 2.2214 (2.1); 2.2114 (3.6); 2.2043 (2.0); 2.2010 (2.2); 2.1952 (2.1); 2.1850 (1.2); 1.5589
(2.7); 1.3340 (0.4); 1.2846 (0.6); 1.2563 (1.4); 1.2145 (0.4); 1.2023 (0.4); 1.1770 (1.1); 1.1637 (4.7);
1.1589 (8.7); 1.1550 (8.3); 1.1493 (8.5); 1.1455 (9.9); 1.1423 (9.6); 1.1369 (5.0); 1.1300 (6.0); 1.1253
(7.2); 1.1203 (4.6); 1.1082 (1.6); 0.8452 (0.6); 0.8402 (0.6); −0.0002 (15.6)
I-707: ¹H-NMR(400.2 MHz, d₆-DMSO):
δ = 9.1195 (0.7); 9.1051 (1.5); 9.0903 (0.7); 7.9529 (0.7); 7.7378 (0.6); 7.7181 (1.7); 7.6984 (1.6);
7.6781 (2.0); 7.6583 (0.8); 7.5940 (2.3); 7.5504 (1.3); 7.5305 (1.0); 7.1945 (2.5); 7.1472 (0.7); 7.1275
(2.0); 7.1086 (2.8); 7.0892 (1.0); 5.6863 (0.4); 5.6753 (0.6); 5.6695 (0.5); 5.6581 (0.4); 5.5673 (0.4);
5.5560 (0.6); 5.5496 (0.5); 5.5387 (0.5); 3.8449 (0.4); 3.8280 (0.6); 3.8156 (0.7); 3.8013 (0.8); 3.7899
(0.5); 3.7813 (0.6); 3.7657 (0.5); 3.7534 (0.5); 3.7388 (0.5); 3.7274 (0.4); 3.3249 (17.0); 2.8909 (4.7);
2.7320 (4.1); 2.5243 (0.6); 2.5066 (24.8); 2.5022 (32.1); 2.4978 (23.3); 2.2658 (14.2); 2.1844 (16.0);
1.2400 (0.7); 0.0078 (0.3); −0.0002 (8.4)
I-708: ¹H-NMR(400.2 MHz, d₆-DMSO):
δ = 9.2443 (0.6); 9.2296 (1.4); 9.2148 (0.7); 7.9532 (0.9); 7.7419 (0.6); 7.7223 (1.7); 7.7026 (1.6);
7.6820 (1.8); 7.6624 (0.8); 7.6225 (2.1); 7.5709 (1.2); 7.5512 (0.9); 7.5269 (1.4); 7.5074 (1.8); 7.3961
(2.7); 7.3716 (1.0); 7.1086 (1.0); 6.9688 (2.5); 6.8293 (1.2); 6.0356 (0.4); 6.0283 (0.4); 6.0186 (0.4);
6.0108 (0.4); 5.9191 (0.4); 5.9108 (0.4); 5.9014 (0.4); 5.8929 (0.4); 3.8698 (0.3); 3.8612 (0.4); 3.8558
(0.4); 3.8106 (0.3); 3.8009 (0.4); 3.7931 (0.8); 3.7871 (0.5); 3.7773 (0.6); 3.7557 (0.5); 3.7394 (0.6);
3.7215 (0.4); 3.3250 (19.5); 2.8910 (7.3); 2.7327 (5.9); 2.7315 (6.2); 2.5249 (0.6); 2.5201 (1.0);
2.5115 (13.3); 2.5070 (27.7); 2.5024 (36.7); 2.4978 (26.0); 2.4932 (12.2); 2.4115 (10.0); 2.2472
(16.0); 1.2397 (0.6); 0.0080 (0.5); −0.0002 (14.5); −0.0086 (0.4)
I-709: ¹H-NMR(400.2 MHz, d₆-DMSO):
δ = 9.1812 (0.7); 9.1665 (1.4); 9.1516 (0.7); 7.9536 (0.9); 7.7451 (0.6); 7.7255 (1.6); 7.7058 (1.5);
7.6846 (1.8); 7.6647 (0.8); 7.5969 (2.2); 7.5576 (1.2); 7.5373 (0.9); 7.4331 (2.2); 7.4133 (2.5); 7.2915
(2.5); 7.1229 (1.4); 7.1032 (1.2); 6.0165 (0.4); 6.0034 (0.9); 5.9904 (0.4); 5.9002 (0.4); 5.8874 (0.9);
5.8739 (0.4); 3.9123 (0.8); 3.8982 (1.4); 3.8842 (0.8); 3.8548 (0.8); 3.8407 (1.4); 3.8268 (0.8); 3.3251
(16.5); 2.8915 (6.7); 2.7325 (5.6); 2.5252 (0.5); 2.5203 (0.8); 2.5117 (11.9); 2.5073 (24.2); 2.5028 (31.7);
2.4983 (22.8); 2.4939 (11.0); 2.2668 (16.0); 2.2595 (9.9); 1.2393 (0.7); −0.0002 (9.2); −0.0082 (0.3)
I-710: ¹H-NMR(400.2 MHz, d₆-DMSO):
δ = 9.2107 (0.7); 9.1959 (1.4); 9.1811 (0.7); 7.7435 (0.6); 7.7239 (1.7); 7.7042 (1.6); 7.6826 (1.9);
7.6629 (0.8); 7.6057 (2.3); 7.5641 (1.2); 7.5439 (1.0); 7.3968 (2.2); 7.3760 (2.7); 7.2792 (2.2); 7.2301
(1.4); 7.2250 (1.2); 7.2094 (1.1); 7.2042 (1.0); 5.9691 (0.4); 5.9602 (0.5); 5.9518 (0.5); 5.9428 (0.4);
5.8524 (0.4); 5.8433 (0.5); 5.8351 (0.6); 5.8263 (0.4); 3.8461 (0.4); 3.8368 (0.4); 3.8323 (0.4); 3.8228
(0.3); 3.7930 (0.4); 3.7781 (0.8); 3.7699 (0.5); 3.7646 (0.6); 3.7605 (0.6); 3.7571 (0.6); 3.7401 (0.6);
3.7241 (0.7); 3.7070 (0.4); 3.3249 (19.3); 2.8912 (0.4); 2.7316 (0.4); 2.5249 (0.6); 2.5200 (1.0);
2.5115 (13.9); 2.5070 (28.3); 2.5025 (37.0); 2.4979 (26.4); 2.4934 (12.5); 2.3494 (10.8); 2.2774
(16.0); 1.2393 (1.0); 0.0080 (0.4); −0.0002 (11.9); −0.0085 (0.4)
I-711: ¹H-NMR(400.2 MHz, d₆-DMSO):
δ = 9.1772 (0.7); 9.1626 (1.4); 9.1478 (0.7); 7.9534 (1.1); 7.7452 (0.6); 7.7257 (1.7); 7.7061 (1.6);
7.6857 (1.9); 7.6660 (0.8); 7.6099 (2.2); 7.5609 (1.2); 7.5412 (0.9); 7.4165 (2.4); 7.3963 (2.6); 7.1789
(2.7); 7.0124 (1.4); 7.0084 (1.4); 6.9921 (1.3); 6.9880 (1.3); 5.9994 (0.4); 5.9865 (1.0); 5.9735 (0.4);
5.8836 (0.4); 5.8707 (0.9); 5.8573 (0.4); 3.9035 (0.8); 3.8896 (1.4); 3.8756 (0.8); 3.8460 (0.7); 3.8322
(1.3); 3.8180 (0.8); 3.3249 (21.3); 2.8914 (7.9); 2.7329 (6.7); 2.7319 (6.5); 2.5252 (0.6); 2.5204 (1.0);
2.5117 (13.8); 2.5072 (28.1); 2.5027 (37.0); 2.4981 (26.4); 2.4936 (12.5); 2.2547 (16.0); 1.9235 (0.6);
1.9150 (0.6); 1.9027 (1.2); 1.8902 (0.7); 1.8818 (0.6); 1.8691 (0.3); 1.2394 (0.8); 0.9859 (0.5); 0.9828
(0.5); 0.9749 (2.0); 0.9694 (2.2); 0.9620 (1.0); 0.9586 (0.9); 0.9540 (2.0); 0.9484 (2.1); 0.9412 (0.5);
0.9379 (0.6); 0.6791 (0.9); 0.6665 (2.2); 0.6624 (1.8); 0.6552 (2.0); 0.6503 (1.4); 0.6426 (0.8); 0.0080
(0.4); −0.0002 (11.2); −0.0085 (0.4)
I-712: ¹H-NMR(400.2 MHz, d₆-DMSO):
δ = 9.2105 (0.7); 9.1958 (1.4); 9.1811 (0.7); 7.7450 (0.6); 7.7254 (1.7); 7.7057 (1.6); 7.6837 (1.8);
7.6641 (0.8); 7.6109 (2.2); 7.5651 (1.2); 7.5449 (0.9); 7.4227 (2.3); 7.3689 (0.7); 7.3644 (0.6); 7.3481
(1.9); 7.3435 (1.8); 7.3251 (3.6); 7.3043 (1.3); 5.9567 (0.4); 5.9482 (0.5); 5.9395 (0.5); 5.9308 (0.4);
5.8400 (0.4); 5.8312 (0.5); 5.8229 (0.6); 5.8139 (0.5); 3.8440 (0.4); 3.8349 (0.4); 3.8300 (0.4); 3.8209
(0.3); 3.7891 (0.4); 3.7725 (0.7); 3.7627 (0.5); 3.7545 (0.6); 3.7349 (0.6); 3.7190 (0.7); 3.7016 (0.4);
3.3262 (19.9); 2.8914 (2.0); 2.7329 (1.7); 2.7317 (1.7); 2.5252 (0.6); 2.5205 (0.8); 2.5118 (11.5);
2.5073 (23.5); 2.5027 (30.8); 2.4981 (22.0); 2.4936 (10.4); 2.3462 (10.8); 2.3297 (0.3); 2.2749 (16.0);
1.2392 (1.0); −0.0002 (7.0)
I-713: ¹H-NMR(400.2 MHz, d₆-DMSO):
δ = 9.1851 (0.7); 9.1706 (1.5); 9.1560 (0.7); 7.9524 (1.1); 7.2033 (2.4); 7.1689 (0.8); 7.1484 (2.6);
7.1450 (2.6); 7.1362 (3.7); 7.1164 (0.7); 7.0962 (0.9); 7.0919 (1.0); 7.0741 (1.3); 7.0578 (0.6); 7.0538
(0.6); 6.9384 (0.7); 6.9344 (0.7); 6.9186 (1.2); 6.9021 (0.7); 6.8985 (0.6); 5.6872 (0.4); 5.6762 (0.6);
5.6695 (0.5); 5.6585 (0.4); 5.5674 (0.4); 5.5568 (0.6); 5.5492 (0.5); 5.5385 (0.5); 3.8386 (0.4); 3.8208
(0.6); 3.8139 (0.4); 3.8066 (0.7); 3.7936 (0.9); 3.7791 (0.6); 3.7600 (0.5); 3.7428 (0.4); 3.7284 (0.5);
3.7174 (0.4); 3.3240 (16.5); 2.8904 (8.4); 2.7321 (7.0); 2.7309 (6.9); 2.5241 (0.5); 2.5194 (0.9);
2.5108 (12.2); 2.5063 (25.1); 2.5017 (33.0); 2.4971 (23.3); 2.4925 (10.9); 2.2580 (16.0); 2.2383 (0.3);
2.1983 (12.6); 2.1906 (8.4); 2.0930 (0.3); 2.0803 (0.5); 2.0720 (0.6); 2.0594 (1.1); 2.0465 (0.6);
2.0384 (0.6); 1.2397 (0.6); 1.0407 (0.8); 1.0298 (2.1); 1.0243 (2.2); 1.0197 (1.2); 1.0140 (1.2); 1.0086
(2.1); 1.0032 (2.2); 0.9930 (0.8); 0.7926 (0.9); 0.7822 (2.3); 0.7771 (2.4); 0.7696 (2.2); 0.7643 (2.4);
0.7531 (0.7); 0.0081 (0.3); −0.0002 (9.6)
I-714: ¹H-NMR(400.2 MHz, d₆-DMSO):
δ = 9.2991 (0.8); 9.2843 (1.7); 9.2698 (0.8); 7.9524 (1.6); 7.5463 (1.6); 7.5361 (0.5); 7.5253 (2.2);
7.4082 (3.2); 7.1752 (0.7); 7.1555 (2.1); 7.1362 (2.1); 7.1252 (1.1); 7.1205 (1.4); 7.1078 (1.8); 7.0872
(0.6); 7.0831 (0.6); 6.9706 (2.6); 6.9438 (0.8); 6.9394 (0.9); 6.9246 (1.5); 6.9077 (0.8); 6.9041 (0.8);
6.8309 (1.2); 6.0424 (0.5); 6.0351 (0.5); 6.0250 (0.6); 6.0172 (0.5); 5.9244 (0.5); 5.9168 (0.5); 5.9078
(0.6); 5.8994 (0.5); 3.8562 (0.4); 3.8476 (0.5); 3.8432 (0.5); 3.8341 (0.4); 3.8007 (0.5); 3.7849 (0.9);
3.7732 (0.6); 3.7650 (0.8); 3.7471 (0.6); 3.7307 (0.8); 3.7137 (0.4); 3.3252 (19.6); 2.8905 (10.5);
2.7311 (9.5); 2.5065 (29.8); 2.5021 (40.6); 2.4977 (32.0); 2.4195 (11.9); 2.2508 (16.0); 2.0812 (0.6);
2.0727 (0.7); 2.0604 (1.2); 2.0476 (0.8); 2.0395 (0.7); 2.0261 (0.3); 1.2391 (0.9); 1.0385 (0.8); 1.0273
(2.2); 1.0220 (2.5); 1.0118 (1.3); 1.0063 (2.3); 1.0010 (2.5); 0.9908 (0.9); 0.7930 (0.9); 0.7777 (3.0);
0.7698 (2.6); 0.7649 (2.9); 0.7536 (0.8); 0.0079 (0.3); −0.0002 (9.5); −0.0082 (0.5)
I-715: ¹H-NMR(400.2 MHz, d₆-DMSO):
δ = 9.1749 (0.6); 9.1605 (1.3); 9.1459 (0.6); 7.9529 (1.5); 7.4088 (2.0); 7.3889 (2.2); 7.2161 (2.2);
7.1670 (0.6); 7.1475 (1.6); 7.1274 (1.2); 7.0881 (0.8); 7.0840 (0.9); 7.0679 (1.1); 7.0660 (1.1); 7.0497
(0.6); 7.0455 (0.6); 7.0369 (1.2); 7.0170 (1.1); 6.9391 (0.7); 6.9351 (0.7); 6.9192 (1.2); 6.9026 (0.6);
6.8990 (0.5); 5.8089 (0.4); 5.7981 (0.5); 5.7925 (0.4); 5.7817 (0.4); 5.6900 (0.4); 5.6791 (0.5); 5.6734
(0.4); 5.6625 (0.4); 3.9194 (0.4); 3.9033 (0.7); 3.8970 (0.5); 3.8873 (0.9); 3.8618 (16.0); 3.8350 (0.6);
3.8202 (0.5); 3.8091 (0.3); 3.3250 (21.8); 2.8911 (11.3); 2.7325 (9.7); 2.7313 (9.3); 2.5246 (0.6);
2.5199 (0.9); 2.5113 (12.0); 2.5068 (24.2); 2.5022 (31.6); 2.4976 (22.2); 2.4931 (10.4); 2.2499 (14.3);
2.0785 (0.5); 2.0703 (0.5); 2.0577 (1.0); 2.0448 (0.6); 2.0368 (0.5); 1.2398 (0.6); 1.0387 (0.7); 1.0277
(1.9); 1.0222 (2.0); 1.0177 (1.0); 1.0119 (1.0); 1.0066 (1.9); 1.0011 (1.9); 0.9909 (0.8); 0.7927 (0.8);
0.7823 (2.1); 0.7773 (2.1); 0.7697 (2.0); 0.7645 (2.1); 0.7533 (0.7); −0.0002 (9.6)
I-716: ¹H-NMR(400.2 MHz, d₆-DMSO):
δ = 9.1394 (0.7); 9.1249 (1.4); 9.1102 (0.7); 7.9528 (1.4); 7.7084 (2.4); 7.7042 (2.5); 7.6088 (2.1);
7.5881 (2.7); 7.4456 (1.4); 7.4409 (1.4); 7.4246 (1.1); 7.4200 (1.1); 7.1677 (0.7); 7.1480 (1.8); 7.1280
(1.3); 7.0756 (0.9); 7.0716 (1.0); 7.0535 (1.3); 7.0371 (0.6); 7.0333 (0.6); 6.9384 (0.8); 6.9346 (0.8);
6.9186 (1.3); 6.9020 (0.7); 6.8985 (0.6); 5.8764 (0.4); 5.8641 (0.7); 5.8511 (0.4); 5.7596 (0.4); 5.7479
(0.7); 5.7345 (0.5); 3.9642 (0.4); 3.9487 (0.6); 3.9330 (0.4); 3.9273 (0.4); 3.9060 (0.4); 3.8904 (0.8);
3.8860 (0.6); 3.8744 (0.5); 3.8416 (0.4); 3.8356 (0.3); 3.8279 (0.5); 3.8167 (0.4); 3.3248 (21.7);
2.8910 (10.5); 2.7317 (8.9); 2.5248 (0.6); 2.5198 (0.9); 2.5112 (13.8); 2.5068 (28.4); 2.5023 (37.5);
2.4977 (26.9); 2.4932 (12.8); 2.2252 (16.0); 2.0793 (0.5); 2.0711 (0.6); 2.0584 (1.2); 2.0454 (0.7);
2.0374 (0.6); 1.2394 (0.9); 1.0395 (0.7); 1.0285 (2.1); 1.0231 (2.2); 1.0187 (1.2); 1.0128 (1.2); 1.0074
(2.1); 1.0020 (2.2); 0.9919 (0.8); 0.7929 (0.9); 0.7825 (2.4); 0.7775 (2.5); 0.7699 (2.3); 0.7647 (2.5);
0.7535 (0.7); −0.0002 (9.9); −0.0086 (0.3)
I-717: ¹H-NMR(400.2 MHz, d₆-DMSO):
δ = 9.2425 (0.5); 9.2280 (1.0); 9.2130 (0.5); 7.9528 (1.0); 7.4496 (1.6); 7.4298 (1.8); 7.3059 (1.8);
7.1770 (0.4); 7.1574 (1.3); 7.1483 (1.1); 7.1376 (1.1); 7.1296 (0.9); 7.1092 (0.6); 7.1049 (0.7); 7.0872
(0.9); 7.0709 (0.4); 7.0669 (0.4); 6.9437 (0.5); 6.9397 (0.5); 6.9241 (0.9); 6.9074 (0.5); 6.9035 (0.4);
6.0128 (0.5); 5.8975 (0.4); 3.9054 (0.4); 3.8992 (0.4); 3.8895 (0.8); 3.8741 (0.5); 3.8501 (0.3); 3.8351
(0.7); 3.8236 (0.5); 3.8127 (0.3); 3.3254 (19.1); 2.8908 (7.0); 2.7315 (6.0); 2.5247 (0.4); 2.5112 (8.8);
2.5068 (18.1); 2.5023 (24.0); 2.4977 (17.3); 2.4932 (8.4); 2.2629 (16.0); 2.0851 (0.4); 2.0766 (0.4);
2.0640 (0.7); 2.0513 (0.4); 2.0431 (0.4); 1.2394 (0.5); 1.0438 (0.5); 1.0328 (1.4); 1.0273 (1.5); 1.0229
(0.8); 1.0170 (0.8); 1.0117 (1.4); 1.0063 (1.5); 0.9961 (0.6); 0.7968 (0.6); 0.7865 (1.6); 0.7815 (1.6);
0.7738 (1.5); 0.7687 (1.7); 0.7575 (0.5); −0.0002 (6.4)
I-718: ¹H-NMR(400.2 MHz, d₆-DMSO):
δ = 9.2661 (0.7); 9.2513 (1.5); 9.2366 (0.7); 7.9529 (1.5); 7.4144 (2.2); 7.3936 (2.8); 7.2927 (2.2);
7.2567 (1.5); 7.2515 (1.2); 7.2359 (1.2); 7.2307 (1.0); 7.1768 (0.6); 7.1574 (1.8); 7.1375 (1.6); 7.1182
(1.0); 7.1137 (1.1); 7.0962 (1.3); 7.0800 (0.6); 7.0760 (0.5); 6.9447 (0.7); 6.9404 (0.7); 6.9251 (1.2);
6.9084 (0.7); 6.9046 (0.6); 5.9768 (0.4); 5.9681 (0.5); 5.9592 (0.6); 5.9503 (0.4); 5.8599 (0.4); 5.8507
(0.5); 5.8425 (0.6); 5.8333 (0.5); 3.8321 (0.4); 3.8229 (0.4); 3.8186 (0.4); 3.8092 (0.3); 3.7873 (0.5);
3.7707 (0.6); 3.7644 (0.5); 3.7540 (0.8); 3.7401 (0.5); 3.7351 (0.6); 3.7182 (0.7); 3.7015 (0.4); 3.3255
(31.2); 2.8910 (11.1); 2.7324 (9.3); 2.7314 (9.1); 2.5246 (0.6); 2.5198 (1.1); 2.5113 (14.9); 2.5068
(30.1); 2.5022 (39.3); 2.4976 (27.8); 2.4931 (13.1); 2.3592 (11.0); 2.2739 (16.0); 2.0830 (0.5); 2.0746
(0.6); 2.0618 (1.1); 2.0490 (0.6); 2.0409 (0.6); 1.2395 (0.8); 1.0399 (0.8); 1.0289 (2.1); 1.0235 (2.2);
1.0189 (1.2); 1.0132 (1.2); 1.0078 (2.1); 1.0024 (2.2); 0.9922 (0.9); 0.7946 (0.9); 0.7843 (2.4); 0.7792
(2.4); 0.7716 (2.3); 0.7664 (2.4); 0.7552 (0.8); 0.0080 (0.4); −0.0002 (11.2); −0.0086 (0.4)
I-719: ¹H-NMR(400.2 MHz, d₆-DMSO):
δ = 9.2369 (0.8); 9.2225 (1.5); 9.2075 (0.8); 7.9528 (1.6); 7.4300 (2.5); 7.4098 (2.8); 7.1943 (3.0);
7.1790 (0.7); 7.1595 (1.9); 7.1396 (1.6); 7.1167 (0.9); 7.1123 (1.2); 7.0947 (1.3); 7.0784 (0.6); 7.0745
(0.6); 7.0180 (1.5); 7.0140 (1.5); 6.9977 (1.4); 6.9937 (1.4); 6.9454 (0.7); 6.9413 (0.8); 6.9258 (1.3);
6.9090 (0.7); 6.9055 (0.6); 6.0089 (0.5); 5.9975 (0.7); 5.9829 (0.5); 5.8927 (0.4); 5.8823 (0.7); 5.8779
(0.6); 5.8667 (0.5); 3.9017 (0.4); 3.8864 (1.0); 3.8772 (0.8); 3.8712 (0.7); 3.8666 (0.6); 3.8462 (0.5);
3.8300 (1.0); 3.8153 (1.0); 3.8043 (0.4); 3.3264 (39.4); 2.8910 (11.5); 2.7325 (9.5); 2.7315 (9.7);
2.5248 (0.7); 2.5202 (1.0); 2.5114 (13.8); 2.5070 (29.1); 2.5024 (38.9); 2.4978 (28.5); 2.4934 (14.0);
2.2536 (16.0); 2.0855 (0.6); 2.0769 (0.6); 2.0643 (1.1); 2.0515 (0.7); 2.0433 (0.6); 1.9284 (0.6);
1.9200 (0.7); 1.9075 (1.3); 1.8951 (0.8); 1.8868 (0.7); 1.8740 (0.3); 1.2393 (0.8); 1.0435 (0.8); 1.0324
(2.1); 1.0270 (2.3); 1.0226 (1.3); 1.0167 (1.2); 1.0114 (2.2); 1.0059 (2.3); 0.9958 (0.9); 0.9848 (0.5);
0.9721 (2.3); 0.9662 (2.7); 0.9512 (2.4); 0.9453 (2.5); 0.9330 (0.4); 0.7966 (0.9); 0.7862 (2.4); 0.7812
(2.6); 0.7735 (2.4); 0.7684 (2.6); 0.7572 (0.8); 0.6730 (1.4); 0.6668 (1.1); 0.6617 (2.0); 0.6567 (2.0);
0.6441 (1.4); −0.0002 (10.0); −0.0084 (0.4)
I-720: ¹H-NMR(400.2 MHz, d₆-DMSO):
δ = 9.2636 (0.7); 9.2489 (1.4); 9.2341 (0.7); 7.9529 (1.5); 7.4324 (2.3); 7.3918 (0.8); 7.3873 (0.6);
7.3710 (1.8); 7.3663 (1.7); 7.3422 (3.5); 7.3214 (1.5); 7.1781 (0.6); 7.1583 (1.8); 7.1384 (1.6); 7.1187
(0.9); 7.1141 (1.1); 7.0967 (1.2); 7.0805 (0.6); 7.0764 (0.5); 6.9451 (0.7); 6.9406 (0.7); 6.9257 (1.2);
6.9088 (0.7); 6.9049 (0.6); 5.9645 (0.4); 5.9557 (0.5); 5.9468 (0.5); 5.9380 (0.4); 5.8475 (0.4); 5.8384
(0.5); 5.8302 (0.6); 5.8210 (0.4); 3.8294 (0.3); 3.8203 (0.4); 3.8159 (0.4); 3.8065 (0.3); 3.7845 (0.4);
3.7677 (0.6); 3.7621 (0.5); 3.7514 (0.7); 3.7380 (0.4); 3.7315 (0.6); 3.7149 (0.7); 3.6981 (0.4); 3.3251
(21.8); 2.8909 (11.2); 2.7326 (9.4); 2.7314 (9.4); 2.5248 (0.6); 2.5201 (0.8); 2.5113 (12.4); 2.5068
(25.6); 2.5022 (33.9); 2.4976 (24.2); 2.4931 (11.5); 2.3545 (10.8); 2.2721 (16.0); 2.0841 (0.5); 2.0761
(0.6); 2.0633 (1.1); 2.0504 (0.6); 2.0423 (0.6); 1.2394 (0.8); 1.0405 (0.7); 1.0295 (2.0); 1.0240 (2.2);
1.0195 (1.1); 1.0137 (1.1); 1.0084 (2.1); 1.0029 (2.2); 0.9928 (0.9); 0.7958 (0.9); 0.7854 (2.3); 0.7803
(2.4); 0.7727 (2.2); 0.7676 (2.4); 0.7564 (0.8); −0.0002 (10.0); −0.0085 (0.3)
I-721: ¹H-NMR(499.9 MHz, CDCl3):
δ = 8.2486 (13.7); 7.9807 (1.1); 7.9703 (1.8); 7.9599 (1.2); 7.5458 (6.1); 7.3683 (0.3); 7.3524 (16.0);
7.3335 (0.5); 7.2600 (16.2); 7.1530 (1.1); 7.1365 (3.8); 7.1272 (2.7); 7.1223 (8.0); 7.1143 (2.6);
7.1106 (3.1); 7.0982 (1.0); 7.0943 (0.8); 6.8853 (1.4); 6.8794 (1.4); 6.8720 (2.6); 6.8674 (2.4); 6.8567
(1.5); 6.8532 (1.4); 6.0575 (1.3); 6.0510 (1.5); 6.0445 (1.5); 6.0379 (1.4); 5.9649 (1.3); 5.9584 (1.5);
5.9518 (1.5); 5.9452 (1.4); 5.2982 (2.2); 4.2621 (0.6); 4.2555 (0.7); 4.2491 (0.7); 4.2425 (0.7); 4.2327
(0.8); 4.2261 (0.8); 4.2198 (0.8); 4.2124 (1.2); 4.2051 (0.7); 4.1987 (0.8); 4.1920 (0.7); 4.1823 (0.8);
4.1757 (0.8); 4.1693 (0.8); 4.1627 (0.8); 3.8934 (0.7); 3.8809 (1.0); 3.8695 (0.8); 3.8641 (0.7); 3.8510
(1.0); 3.8478 (1.0); 3.8398 (0.8); 3.8365 (1.1); 3.8237 (0.8); 3.8183 (0.7); 3.8057 (0.8); 3.7944 (0.6);
2.1396 (0.5); 2.1292 (1.2); 2.1225 (1.3); 2.1123 (2.4); 2.1020 (1.4); 2.0954 (1.3); 2.0850 (0.7); 1.5493
(7.4); 1.2554 (0.7); 1.0671 (1.5); 1.0578 (4.4); 1.0541 (4.8); 1.0451 (2.5); 1.0409 (4.7); 1.0371 (4.7);
1.0282 (2.0); 0.8080 (1.9); 0.7986 (5.3); 0.7956 (5.3); 0.7886 (4.9); 0.7854 (5.8); 0.7758 (1.8); 0.0062
(0.7); −0.0002 (18.5)
I-722: ¹H-NMR(499.9 MHz, CDCl3):
δ = 8.2482 (13.2); 7.9705 (1.8); 7.9601 (1.1); 7.5472 (5.7); 7.5456 (6.0); 7.3681 (0.3); 7.3524 (16.0);
7.2600 (15.1); 7.1527 (1.1); 7.1362 (3.8); 7.1269 (3.1); 7.1220 (7.8); 7.1141 (2.6); 7.1103 (2.9);
7.0979 (1.0); 7.0940 (0.7); 6.8850 (1.4); 6.8791 (1.5); 6.8717 (2.7); 6.8673 (2.2); 6.8565 (1.5); 6.8529
(1.3); 6.0574 (1.3); 6.0508 (1.5); 6.0443 (1.5); 6.0377 (1.3); 5.9647 (1.3); 5.9582 (1.5); 5.9516 (1.5);
5.9451 (1.3); 4.2617 (0.6); 4.2551 (0.7); 4.2487 (0.7); 4.2421 (0.7); 4.2324 (0.8); 4.2257 (0.8); 4.2193
(0.8); 4.2120 (1.2); 4.2047 (0.7); 4.1983 (0.7); 4.1917 (0.7); 4.1819 (0.8); 4.1753 (0.8); 4.1689 (0.8);
4.1623 (0.7); 3.8933 (0.7); 3.8825 (1.0); 3.8805 (1.0); 3.8695 (0.8); 3.8640 (0.7); 3.8529 (0.9); 3.8510
(1.0); 3.8477 (1.0); 3.8400 (0.9); 3.8368 (1.1); 3.8236 (0.8); 3.8182 (0.7); 3.8073 (0.8); 3.8053 (0.8);
3.7944 (0.6); 2.1393 (0.5); 2.1289 (1.2); 2.1223 (1.3); 2.1120 (2.3); 2.1017 (1.4); 2.0951 (1.2); 2.0847
(0.6); 1.5510 (5.4); 1.4319 (0.4); 1.2558 (0.6); 1.0669 (1.6); 1.0576 (4.6); 1.0539 (4.6); 1.0503 (2.5);
1.0449 (2.6); 1.0406 (4.7); 1.0369 (4.4); 1.0280 (1.8); 0.8078 (2.0); 0.7986 (5.4); 0.7953 (5.1); 0.7885
(5.0); 0.7852 (5.4); 0.7756 (1.6); −0.0002 (18.0); −0.0067 (0.8)
I-723: ¹H-NMR(499.9 MHz, CDCl3):
δ = 7.4038 (1.9); 7.3868 (3.6); 7.3809 (1.8); 7.3123 (1.2); 7.2959 (2.4); 7.2794 (1.4); 7.2607 (3.8);
7.1846 (1.3); 7.1805 (1.3); 7.1678 (1.2); 7.1638 (1.2); 6.8158 (0.5); 6.8053 (1.8); 6.8017 (1.8); 6.7890
(1.3); 6.7848 (1.2); 6.7529 (1.0); 6.7495 (1.2); 6.7367 (0.9); 6.7334 (1.2); 6.7096 (1.5); 6.7051 (2.4);
6.7006 (1.2); 5.9849 (0.4); 5.9788 (0.5); 5.9714 (0.5); 5.9653 (0.4); 5.8920 (0.4); 5.8858 (0.5); 5.8785
(0.5); 5.8723 (0.4); 5.2970 (0.7); 3.8596 (0.4); 3.8290 (0.4); 3.8149 (0.5); 3.8014 (0.3); 3.7814 (16.0);
2.3418 (13.6); 1.9977 (4.2); 1.2555 (0.4); 1.2093 (0.5); 1.1970 (0.5); −0.0002 (4.2)
I-724: ¹H-NMR(499.9 MHz, CDCl3):
δ = 7.4045 (2.0); 7.3873 (3.9); 7.3127 (1.3); 7.2962 (2.5); 7.2798 (1.4); 7.2608 (4.1); 7.1850 (1.5);
7.1811 (1.4); 7.1683 (1.2); 7.1643 (1.2); 6.8055 (1.8); 6.8011 (2.3); 6.7890 (1.6); 6.7855 (1.4); 6.7534
(1.2); 6.7500 (1.3); 6.7372 (1.1); 6.7340 (1.2); 6.7104 (1.8); 6.7059 (2.6); 6.7014 (1.2); 5.9859 (0.5);
5.9798 (0.6); 5.9725 (0.6); 5.9663 (0.5); 5.8930 (0.5); 5.8868 (0.6); 5.8795 (0.6); 5.8734 (0.5); 4.0918
(0.3); 4.0855 (0.4); 4.0790 (0.4); 4.0726 (0.4); 4.0693 (0.3); 4.0396 (0.3); 4.0332 (0.3); 4.0268 (0.3);
3.8607 (0.5); 3.8479 (0.4); 3.8443 (0.3); 3.8306 (0.5); 3.8161 (0.6); 3.8024 (0.5); 3.7987 (0.6); 3.7817
(16.0); 2.5976 (0.4); 2.3433 (13.6); 1.9980 (6.4); 1.2555 (0.4); −0.0002 (4.6)
I-725: ¹H-NMR(499.9 MHz, CDCl3):
δ = 7.5515 (3.2); 7.3779 (0.6); 7.3749 (0.5); 7.3611 (3.2); 7.3580 (3.6); 7.3535 (5.1); 7.3355 (1.5);
7.3186 (2.6); 7.3026 (1.8); 7.2611 (7.2); 7.2152 (1.5); 7.2134 (1.8); 7.2118 (1.9); 7.1979 (4.1); 7.1955
(3.9); 7.0810 (1.5); 7.0781 (1.4); 7.0766 (1.4); 7.0661 (1.1); 7.0638 (1.3); 7.0624 (1.4); 7.0602 (1.2);
6.5094 (0.6); 6.4975 (1.1); 6.4857 (0.7); 5.9981 (0.6); 5.9919 (0.7); 5.9841 (0.7); 5.9779 (0.7); 5.9048
(0.6); 5.8986 (0.7); 5.8907 (0.7); 5.8846 (0.7); 4.1868 (0.3); 4.1806 (0.4); 4.1735 (0.4); 4.1673 (0.4);
4.1574 (0.4); 4.1511 (0.4); 4.1441 (0.4); 4.1378 (0.4); 4.1329 (0.4); 4.1265 (0.4); 4.1195 (0.4); 4.1132
(0.4); 4.1033 (0.4); 4.0971 (0.4); 4.0901 (0.4); 4.0838 (0.4); 3.8628 (0.4); 3.8492 (0.5); 3.8372 (0.4);
3.8336 (0.4); 3.8193 (0.8); 3.8076 (0.8); 3.7934 (0.4); 3.7897 (0.4); 3.7760 (0.4); 3.7640 (0.3); 2.6249
(0.5); 2.5910 (15.2); 2.2777 (16.0); 2.2573 (0.4); 2.1648 (0.3); 2.0013 (5.8); 1.5814 (1.0); −0.0002
(7.8); −0.0065 (0.5)
I-726: ¹H-NMR(499.9 MHz, CDCl3):
δ = 7.5519 (3.6); 7.3783 (0.7); 7.3751 (0.6); 7.3615 (3.6); 7.3583 (4.3); 7.3539 (5.8); 7.3362 (1.8);
7.3193 (2.8); 7.3033 (1.9); 7.2611 (9.8); 7.2174 (1.2); 7.2158 (1.6); 7.2138 (2.1); 7.2121 (2.1); 7.1987
(4.9); 7.1961 (4.8); 7.1920 (2.2); 7.0834 (1.4); 7.0818 (1.6); 7.0790 (1.6); 7.0774 (1.6); 7.0671 (1.3);
7.0645 (1.6); 7.0634 (1.5); 7.0608 (1.4); 6.5007 (0.7); 6.4893 (1.2); 6.4778 (0.7); 5.9986 (0.7); 5.9924
(0.8); 5.9845 (0.8); 5.9784 (0.8); 5.9052 (0.7); 5.8991 (0.8); 5.8912 (0.8); 5.8850 (0.8); 4.1878 (0.3);
4.1815 (0.4); 4.1745 (0.4); 4.1683 (0.4); 4.1584 (0.4); 4.1521 (0.5); 4.1451 (0.5); 4.1389 (0.5); 4.1338
(0.4); 4.1275 (0.4); 4.1205 (0.4); 4.1142 (0.4); 4.1043 (0.5); 4.0981 (0.5); 4.0911 (0.5); 4.0848 (0.4);
3.8634 (0.4); 3.8518 (0.5); 3.8496 (0.5); 3.8379 (0.5); 3.8342 (0.4); 3.8198 (0.8); 3.8083 (0.8); 3.7940
(0.5); 3.7903 (0.5); 3.7786 (0.4); 3.7763 (0.5); 3.7647 (0.3); 2.5924 (15.7); 2.2786 (16.0); 2.0015
(10.8); 1.5789 (1.7); 1.2549 (0.3); 0.0063 (0.3); −0.0002 (10.9); −0.0066 (0.8)
I-727: ¹H-NMR(499.9 MHz, d₆-DMSO):
δ = 9.1926 (1.9); 7.9731 (5.0); 7.9678 (12.0); 7.9559 (4.9); 7.8883 (4.0); 7.8841 (4.2); 7.7998 (5.6);
7.7890 (6.1); 7.5152 (4.3); 7.5043 (4.0); 7.3316 (3.6); 7.3156 (4.0); 7.2724 (3.2); 7.2681 (3.2); 7.2552
(3.0); 7.2508 (3.2); 7.0737 (4.2); 6.9397 (2.2); 6.9238 (2.1); 4.1243 (1.0); 4.1168 (1.0); 4.0955 (2.0);
4.0872 (1.9); 4.0658 (1.0); 4.0578 (1.0); 3.3269 (60.9); 2.5113 (2.0); 2.5078 (4.1); 2.5043 (5.6);
2.5007 (4.2); 2.4975 (2.1); 2.4209 (11.3); 2.2010 (16.0); 2.0762 (1.6)
I-728: ¹H-NMR(499.9 MHz, d₆-DMSO):
δ = 9.1751 (1.2); 9.1627 (2.6); 9.1502 (1.3); 8.1851 (3.8); 8.1800 (4.0); 7.9723 (13.8); 7.5178 (3.6);
7.5152 (3.3); 7.5129 (3.7); 7.3284 (3.7); 7.3125 (4.1); 7.0847 (4.1); 6.9678 (2.2); 6.9520 (2.0); 4.1196
(1.2); 4.1071 (1.2); 4.0900 (2.8); 4.0774 (2.7); 4.0601 (1.4); 4.0476 (1.3); 3.3198 (6.9); 2.9673 (2.6);
2.9524 (5.1); 2.9442 (4.0); 2.9377 (3.5); 2.9290 (6.0); 2.9136 (3.4); 2.5118 (1.7); 2.5083 (3.5); 2.5046
(4.9); 2.5010 (3.6); 2.4975 (1.8); 2.4215 (11.2); 2.2348 (16.0); 2.1708 (1.1); 2.1642 (0.5); 2.1555
(3.3); 2.1404 (4.5); 2.1320 (0.8); 2.1254 (3.2); 2.1102 (0.9)
I-729: ¹H-NMR(499.9 MHz, CDCl3):
δ = 8.2648 (16.0); 7.8331 (2.4); 7.5532 (7.7); 7.3933 (2.4); 7.3901 (2.3); 7.3766 (6.7); 7.3733 (6.7);
7.3594 (9.7); 7.3427 (3.2); 7.2607 (11.6); 7.2447 (0.5); 7.2275 (4.8); 7.2154 (6.3); 7.2020 (6.0);
7.1944 (2.2); 7.1820 (0.6); 7.1774 (0.4); 7.1533 (1.6); 7.1502 (1.8); 7.1416 (3.2); 7.1377 (3.0); 7.1319
(2.0); 7.1237 (1.5); 7.1182 (0.9); 6.0517 (1.7); 6.0454 (1.8); 6.0381 (1.8); 6.0318 (1.6); 5.9588 (1.7);
5.9524 (1.8); 5.9451 (1.8); 5.9388 (1.6); 4.2702 (0.9); 4.2637 (0.9); 4.2570 (1.0); 4.2505 (0.9); 4.2408
(1.1); 4.2344 (1.1); 4.2276 (1.1); 4.2210 (1.2); 4.2182 (1.2); 4.2114 (1.0); 4.2046 (1.0); 4.1982 (0.9);
4.1885 (1.1); 4.1820 (1.1); 4.1753 (1.1); 4.1688 (0.9); 3.8814 (1.0); 3.8707 (1.2); 3.8681 (1.2); 3.8571
(1.1); 3.8521 (1.0); 3.8378 (1.8); 3.8270 (1.8); 3.8129 (1.1); 3.8080 (1.0); 3.7971 (1.0); 3.7945 (1.0);
3.7836 (0.8); 2.9543 (1.6); 2.8802 (1.5); 1.5576 (3.2); 1.4319 (0.4); 1.2561 (0.4); −0.0002 (13.2)
I-730: ¹H-NMR(499.9 MHz, CDCl3):
δ = 8.2653 (16.0); 7.8328 (2.1); 7.5533 (7.1); 7.3935 (2.2); 7.3901 (1.9); 7.3768 (6.3); 7.3734 (5.9);
7.3596 (9.1); 7.3429 (3.0); 7.2606 (12.7); 7.2451 (0.4); 7.2278 (4.3); 7.2159 (5.5); 7.2024 (5.6);
7.1946 (2.0); 7.1822 (0.5); 7.1536 (1.4); 7.1503 (1.5); 7.1418 (2.9); 7.1378 (2.6); 7.1320 (1.7); 7.1256
(1.3); 7.1237 (1.4); 7.1181 (0.8); 6.0520 (1.5); 6.0456 (1.6); 6.0383 (1.6); 6.0320 (1.4); 5.9590 (1.5);
5.9526 (1.6); 5.9453 (1.6); 5.9390 (1.4); 4.2706 (0.8); 4.2641 (0.8); 4.2574 (0.8); 4.2509 (0.8); 4.2413
(1.0); 4.2348 (1.0); 4.2280 (1.0); 4.2214 (1.1); 4.2184 (1.0); 4.2118 (0.9); 4.2050 (0.9); 4.1986 (0.8);
4.1889 (1.0); 4.1824 (1.0); 4.1757 (1.0); 4.1692 (0.9); 3.8815 (0.9); 3.8708 (1.1); 3.8679 (1.0); 3.8571
(1.0); 3.8522 (0.9); 3.8412 (1.1); 3.8378 (1.6); 3.8270 (1.7); 3.8240 (1.1); 3.8129 (1.0); 3.8079 (0.9);
3.7972 (1.0); 3.7943 (0.9); 3.7836 (0.7); 2.9545 (0.7); 2.8806 (0.7); 2.0041 (0.5); 1.5554 (2.1); 1.2558
(0.3); −0.0002 (14.6); −0.0066 (0.7)
I-731: ¹H-NMR(499.9 MHz, CDCl3):
δ = 8.2345 (11.7); 8.1802 (0.7); 7.9836 (0.9); 7.9733 (1.4); 7.3692 (0.3); 7.3532 (0.4); 7.3378 (3.5);
7.3219 (3.8); 7.2587 (10.3); 7.2155 (0.7); 7.2078 (1.1); 7.2039 (1.4); 7.1969 (1.8); 7.1886 (1.8);
7.1838 (1.8); 7.1799 (2.0); 7.1641 (6.3); 7.1604 (3.0); 7.1524 (4.3); 7.1495 (3.1); 7.1435 (1.8); 7.1326
(0.6); 7.1278 (0.4); 7.0470 (0.4); 7.0247 (4.0); 6.9367 (2.1); 6.9208 (1.9); 4.2397 (1.7); 4.2277 (1.7);
4.2112 (3.8); 4.1992 (3.6); 4.1826 (1.9); 4.1707 (1.8); 4.1279 (0.4); 4.1135 (0.4); 2.7559 (1.4); 2.7409
(4.2); 2.7257 (4.3); 2.7105 (1.5); 2.4961 (0.4); 2.4738 (11.8); 2.3448 (0.6); 2.3239 (1.1); 2.2706
(16.0); 2.0433 (1.6); 1.5585 (9.2); 1.4351 (0.9); 1.2909 (7.6); 1.2758 (15.3); 1.2605 (7.5); 1.2440
(0.7); 0.0061 (0.8); −0.0002 (11.4); −0.0067 (0.4)
I-732: ¹H-NMR(499.9 MHz, CDCl3):
δ = 8.2188 (0.8); 8.2083 (1.3); 8.1979 (0.8); 8.1716 (12.0); 8.1032 (0.3); 7.6105 (2.6); 7.5954 (2.8);
7.3737 (4.9); 7.3657 (7.1); 7.2836 (1.2); 7.2760 (1.7); 7.2680 (1.6); 7.2579 (8.4); 7.2514 (1.0); 7.1632
(3.2); 7.1473 (3.7); 7.0131 (3.7); 6.9504 (2.0); 6.9346 (1.8); 6.9107 (1.8); 6.9042 (2.0); 6.8974 (2.0);
6.8909 (1.9); 5.2955 (10.2); 4.0696 (0.8); 4.0576 (1.4); 4.0451 (1.0); 4.0371 (1.3); 4.0305 (1.7);
4.0253 (1.8); 4.0187 (1.3); 4.0101 (1.1); 3.9981 (1.5); 3.9864 (0.8); 3.2461 (0.6); 3.2308 (0.9); 3.2146
(1.2); 3.1984 (1.2); 3.1841 (0.9); 3.0448 (0.8); 3.0362 (0.9); 3.0276 (1.1); 3.0190 (1.0); 3.0126 (0.7);
3.0039 (0.7); 2.9952 (0.8); 2.9866 (0.8); 2.8180 (0.6); 2.8048 (1.2); 2.8008 (0.7); 2.7912 (0.8); 2.7878
(1.4); 2.7759 (1.6); 2.7722 (0.9); 2.7627 (0.8); 2.7587 (1.2); 2.7455 (0.5); 2.3893 (10.7); 2.3530 (0.7);
2.3460 (0.9); 2.3446 (1.0); 2.3370 (1.2); 2.3299 (1.3); 2.3242 (1.0); 2.3213 (1.0); 2.3080 (16.0);
2.2926 (0.7); 1.5674 (6.6); −0.0002 (9.4); −0.0067 (0.5)
I-733: ¹H-NMR(499.9 MHz, CDCl3):
δ = 8.2515 (16.0); 8.0873 (1.3); 8.0769 (1.9); 7.4022 (5.8); 7.3951 (4.7); 7.3916 (6.3); 7.3888 (5.6);
7.3857 (6.8); 7.3729 (3.4); 7.3570 (6.6); 7.3412 (3.7); 7.2596 (19.1); 7.1896 (3.9); 7.1857 (3.7);
7.1728 (3.2); 7.1688 (3.1); 7.0526 (3.7); 7.0369 (3.3); 6.9739 (3.0); 6.9707 (3.0); 6.9692 (3.1); 6.9578
(2.6); 6.9545 (2.7); 6.9530 (2.8); 6.9044 (4.1); 6.9005 (5.6); 6.8968 (3.4); 6.0577 (1.3); 6.0513 (1.4);
6.0440 (1.4); 6.0375 (1.3); 5.9648 (1.3); 5.9584 (1.4); 5.9511 (1.4); 5.9446 (1.2); 5.2978 (6.1); 4.2593
(0.8); 4.2527 (0.8); 4.2461 (0.9); 4.2395 (0.8); 4.2300 (1.0); 4.2234 (1.0); 4.2168 (1.0); 4.2101 (1.0);
4.2070 (1.0); 4.2003 (0.8); 4.1937 (0.9); 4.1870 (0.8); 4.1775 (0.9); 4.1709 (0.9); 4.1643 (0.9); 4.1577
(0.8); 3.8380 (0.9); 3.8276 (1.0); 3.8244 (1.0); 3.8138 (0.9); 3.8087 (0.9); 3.7981 (1.0); 3.7946 (1.6);
3.7842 (1.6); 3.7809 (1.0); 3.7701 (0.9); 3.7650 (0.8); 3.7546 (0.8); 3.7513 (0.8); 3.7408 (0.6); 2.9550
(0.8); 2.8827 (0.8); 1.9696 (0.8); 1.9594 (1.6); 1.9527 (1.7); 1.9427 (2.9); 1.9327 (1.7); 1.9259 (1.5);
1.9157 (0.8); 1.5528 (2.7); 1.2552 (0.4); 1.0487 (0.4); 1.0369 (2.3); 1.0273 (5.4); 1.0238 (5.4); 1.0204
(3.2); 1.0145 (2.9); 1.0105 (5.4); 1.0069 (4.8); 0.9978 (2.1); 0.7833 (0.4); 0.7728 (0.4); 0.7533 (2.6);
0.7437 (6.7); 0.7405 (5.8); 0.7340 (5.4); 0.7306 (6.5); 0.7209 (1.8); 0.0062 (1.4); −0.0002
(22.0); −0.0067 (0.9)
I-734: ¹H-NMR(499.9 MHz, CDCl3):
δ = 8.1135 (5.1); 7.8640 (0.8); 7.6027 (1.0); 7.5992 (1.2); 7.5829 (1.8); 7.5759 (1.2); 7.5686 (1.0);
7.5461 (2.7); 7.3932 (0.8); 7.3899 (0.8); 7.3824 (1.3); 7.3766 (3.0); 7.3733 (3.3); 7.3668 (5.4); 7.3502
(1.4); 7.2605 (11.0); 6.0588 (0.6); 6.0523 (0.6); 6.0452 (0.6); 6.0387 (0.6); 5.9658 (0.6); 5.9593 (0.6);
5.9522 (0.6); 5.9457 (0.6); 5.2988 (2.2); 4.2720 (0.3); 4.2655 (0.4); 4.2589 (0.4); 4.2523 (0.4); 4.2427
(0.4); 4.2362 (0.4); 4.2296 (0.4); 4.2228 (0.4); 4.2200 (0.4); 4.2133 (0.3); 4.2067 (0.4); 4.2001 (0.3);
4.1905 (0.4); 4.1840 (0.4); 4.1774 (0.4); 4.1708 (0.3); 3.8858 (0.4); 3.8751 (0.4); 3.8723 (0.5); 3.8615
(0.4); 3.8566 (0.4); 3.8457 (0.4); 3.8421 (0.6); 3.8313 (0.6); 3.8283 (0.5); 3.8173 (0.4); 3.8124 (0.4);
3.8016 (0.4); 3.7988 (0.4); 2.9553 (0.8); 2.8828 (0.8); 2.7280 (16.0); 1.5518 (5.1); 0.0062
(0.8); −0.0002 (13.3); −0.0064 (1.0)
I-735: ¹H-NMR(499.9 MHz, CDCl3):
δ = 8.1135 (5.2); 7.8750 (0.5); 7.8645 (0.7); 7.8541 (0.4); 7.6027 (0.9); 7.5993 (1.0); 7.5899 (1.3);
7.5861 (1.5); 7.5828 (1.5); 7.5754 (0.9); 7.5686 (0.9); 7.5459 (2.5); 7.3931 (0.8); 7.3898 (0.8); 7.3824
(1.2); 7.3764 (2.8); 7.3731 (3.0); 7.3667 (5.0); 7.3501 (1.3); 7.2606 (9.1); 6.0588 (0.6); 6.0523 (0.6);
6.0452 (0.6); 6.0387 (0.5); 5.9658 (0.6); 5.9593 (0.6); 5.9521 (0.6); 5.9456 (0.5); 5.2986 (10.5);
4.2718 (0.3); 4.2652 (0.3); 4.2586 (0.3); 4.2520 (0.3); 4.2425 (0.4); 4.2359 (0.4); 4.2293 (0.4); 4.2226
(0.4); 4.2198 (0.4); 4.2064 (0.3); 4.1903 (0.4); 4.1837 (0.3); 4.1771 (0.3); 3.8860 (0.4); 3.8752 (0.4);
3.8725 (0.4); 3.8616 (0.4); 3.8567 (0.3); 3.8458 (0.4); 3.8423 (0.6); 3.8314 (0.6); 3.8284 (0.4); 3.8175
(0.4); 3.8125 (0.3); 3.8018 (0.3); 2.7279 (16.0); 1.5625 (0.5); 0.0063 (0.6); −0.0002 (11.0); −0.0068 (0.4)
I-736: ¹H-NMR(499.9 MHz, CDCl3):
δ = 8.2513 (16.0); 8.0874 (1.2); 8.0771 (1.8); 7.4024 (5.6); 7.3952 (4.6); 7.3917 (5.9); 7.3887 (5.4);
7.3858 (6.8); 7.3729 (3.4); 7.3570 (6.6); 7.3412 (3.9); 7.2597 (18.6); 7.1897 (3.9); 7.1857 (3.8);
7.1729 (3.3); 7.1689 (3.2); 7.0525 (3.6); 7.0369 (3.2); 6.9754 (2.6); 6.9739 (2.7); 6.9707 (3.0); 6.9691
(2.9); 6.9593 (2.4); 6.9577 (2.4); 6.9545 (2.8); 6.9529 (2.6); 6.9046 (4.1); 6.9007 (5.5); 6.8967 (3.4);
6.0579 (1.3); 6.0514 (1.4); 6.0442 (1.4); 6.0377 (1.3); 5.9650 (1.3); 5.9585 (1.4); 5.9512 (1.4); 5.9447
(1.2); 5.2977 (3.9); 4.2592 (0.8); 4.2526 (0.8); 4.2460 (0.8); 4.2394 (0.8); 4.2299 (0.9); 4.2233 (0.9);
4.2167 (0.9); 4.2100 (1.0); 4.2069 (1.0); 4.2002 (0.8); 4.1935 (0.8); 4.1870 (0.8); 4.1774 (0.9); 4.1708
(0.9); 4.1642 (0.9); 4.1576 (0.8); 3.8380 (0.9); 3.8277 (1.0); 3.8243 (1.0); 3.8139 (1.0); 3.8087 (0.9);
3.7983 (0.9); 3.7946 (1.7); 3.7842 (1.7); 3.7807 (1.0); 3.7702 (0.9); 3.7650 (0.9); 3.7547 (0.8); 3.7512
(0.8); 3.7409 (0.7); 2.9546 (0.8); 2.8823 (0.7); 1.9696 (0.8); 1.9595 (1.5); 1.9527 (1.6); 1.9498 (1.1);
1.9427 (2.9); 1.9357 (1.1); 1.9327 (1.7); 1.9259 (1.6); 1.9158 (0.8); 1.5525 (4.3); 1.2552 (0.4); 1.0368
(2.1); 1.0273 (5.0); 1.0237 (5.3); 1.0203 (3.0); 1.0145 (2.9); 1.0105 (5.3); 1.0069 (5.0); 0.9977 (2.3);
0.9845 (0.4); 0.7729 (0.3); 0.7533 (2.4); 0.7437 (6.5); 0.7405 (5.7); 0.7340 (5.4); 0.7306 (6.8); 0.7208
(2.1); 0.0700 (1.2); 0.0063 (1.0); −0.0002 (22.6); −0.0068 (1.1)
I-737: ¹H-NMR(400.1 MHz, d₆-DMSO):
δ = 9.3695 (1.0); 9.3551 (1.9); 9.3408 (0.9); 7.9614 (1.9); 7.3434 (2.3); 7.3233 (2.5); 7.2770 (7.8);
7.1002 (3.6); 6.9819 (2.0); 6.9624 (1.8); 4.1731 (0.9); 4.1585 (1.0); 4.1368 (1.9); 4.1212 (1.8); 4.0991
(1.0); 4.0848 (0.9); 3.3142 (66.7); 3.1281 (0.6); 3.0986 (1.2); 3.0769 (1.2); 3.0472 (0.6); 2.8997 (8.5);
2.7406 (8.1); 2.5105 (17.6); 2.4455 (9.5); 2.4132 (0.6); 2.2674 (0.6); 2.2231 (16.0); 2.1891 (0.3);
2.1274 (0.6); 2.1142 (0.7); 2.0976 (1.2); 2.0816 (1.5); 2.0698 (1.4); 2.0546 (1.5); 2.0343 (0.9); 1.3613
(0.6); 1.3454 (0.5)
I-738: ¹H-NMR(400.1 MHz, d₆-DMSO):
δ = 9.2187 (2.2); 7.9612 (2.6); 7.6528 (3.0); 7.5666 (2.6); 7.5459 (3.2); 7.4062 (1.6); 7.3819 (2.2);
7.3583 (1.2); 7.2825 (8.6); 6.0587 (1.3); 5.9441 (1.3); 3.9967 (0.3); 3.9368 (1.5); 3.8883 (1.4); 3.3132
(83.3); 3.1306 (0.7); 3.1020 (1.4); 3.0791 (1.5); 3.0486 (0.7); 2.8997 (11.8); 2.7407 (11.2); 2.5106
(23.1); 2.4126 (0.6); 2.4010 (0.6); 2.2715 (16.0); 2.1480 (0.3); 2.1007 (1.5); 2.0819 (1.8); 2.0682
(1.6); 2.0547 (1.9); 2.0335 (1.1); 1.4004 (0.6); 1.3838 (0.6); 1.3613 (0.6); 1.3446 (0.6)
I-739: ¹H-NMR(300.2 MHz, CDCl3):
δ = 7.4171 (2.5); 7.4101 (2.7); 7.3099 (2.1); 7.2991 (2.3); 7.2825 (2.8); 7.2168 (0.5); 7.1264 (1.8);
7.1193 (2.1); 7.0990 (1.6); 7.0914 (3.1); 7.0806 (1.6); 7.0689 (3.8); 7.0595 (1.2); 7.0524 (1.4); 7.0324
(0.4); 6.8467 (0.7); 6.8353 (0.7); 6.8254 (1.2); 6.8169 (1.1); 6.8002 (0.7); 6.7933 (0.6); 4.1853 (0.4);
4.1628 (0.9); 4.1370 (2.0); 4.1102 (2.4); 4.0860 (1.1); 4.0617 (0.4); 4.0073 (1.4); 3.6028 (16.0);
3.2442 (1.8); 3.2204 (3.6); 3.1952 (1.7); 2.3522 (15.6); 2.1375 (0.6); 2.1266 (0.6); 2.1094 (1.1);
2.0923 (0.6); 2.0813 (0.7); 2.0396 (1.3); 1.6435 (1.2); 1.3003 (0.9); 1.0575 (0.7); 1.0438 (1.8); 1.0373
(2.0); 1.0236 (1.1); 1.0155 (1.9); 1.0088 (1.8); 0.9954 (0.7); 0.9387 (0.3); 0.9169 (0.9); 0.8935 (0.4);
0.8076 (1.0); 0.7906 (2.2); 0.7863 (2.0); 0.7745 (2.2); 0.7691 (1.6); 0.7568 (0.7); 0.0358 (2.7)
I-740: ¹H-NMR(300.2 MHz, CDCl3):
δ = 7.3970 (3.8); 7.3906 (4.5); 7.3751 (5.6); 7.2985 (1.7); 7.2706 (2.4); 7.2435 (3.6); 7.1226 (1.0);
7.0964 (5.0); 7.0707 (6.4); 7.0430 (1.9); 7.0209 (0.6); 6.8521 (1.4); 6.8437 (1.1); 6.8297 (2.5); 6.8230
(2.0); 6.8048 (1.2); 6.7989 (1.2); 6.3406 (0.5); 5.3226 (1.6); 4.1302 (2.2); 4.1069 (4.3); 4.0833 (2.4);
3.9689 (1.7); 3.8635 (0.5); 3.8576 (0.5); 3.6161 (16.0); 3.2059 (2.3); 3.1986 (1.4); 3.1824 (4.1);
3.1591 (2.2); 3.0985 (0.6); 2.1575 (0.4); 2.1404 (0.9); 2.1292 (1.1); 2.1123 (1.9); 2.0954 (1.1); 2.0842
(1.0); 2.0668 (0.5); 1.2893 (1.5); 1.0625 (1.2); 1.0466 (3.1); 1.0409 (3.2); 1.0187 (3.0); 1.0133 (2.8);
0.9982 (1.0); 0.9332 (0.4); 0.9117 (1.2); 0.8886 (0.5); 0.8103 (1.7); 0.7950 (4.7); 0.7903 (4.6); 0.7784
(4.0); 0.7729 (4.8); 0.7563 (1.3); 0.0320 (1.5)
I-741: ¹H-NMR(499.9 MHz, CDCl3):
δ = 7.5276 (0.5); 7.5121 (1.7); 7.4964 (2.1); 7.4896 (2.4); 7.4739 (0.7); 7.4415 (2.3); 7.4197 (2.4);
7.4030 (2.9); 7.3945 (2.0); 7.3913 (2.7); 7.3886 (2.1); 7.3724 (1.4); 7.3571 (1.1); 7.2627 (2.8); 7.2208
(1.8); 7.2168 (1.7); 7.2040 (1.5); 7.2000 (1.4); 6.6699 (0.6); 6.6580 (1.0); 6.6460 (0.6); 6.0104 (0.6);
6.0044 (0.6); 5.9961 (0.6); 5.9900 (0.6); 5.9170 (0.6); 5.9109 (0.6); 5.9026 (0.6); 5.8965 (0.6); 5.2959
(1.5); 4.1796 (0.3); 4.1734 (0.3); 4.1664 (0.3); 4.1602 (0.3); 4.1502 (0.4); 4.1440 (0.4); 4.1370 (0.4);
4.1308 (0.4); 4.1246 (0.4); 4.1113 (0.3); 4.1051 (0.3); 4.0951 (0.4); 4.0889 (0.4); 4.0819 (0.4); 4.0757
(0.4); 3.8500 (0.4); 3.8383 (0.4); 3.8357 (0.4); 3.8240 (0.4); 3.8207 (0.4); 3.8069 (0.7); 3.7951 (0.7);
3.7811 (0.4); 3.7779 (0.4); 3.7661 (0.4); 3.7635 (0.4); 2.5682 (15.8); 2.2644 (16.0); −0.0002 (3.2)
I-742: ¹H-NMR(499.9 MHz, CDCl3):
δ = 7.5292 (0.6); 7.5137 (1.8); 7.4981 (2.2); 7.4906 (2.6); 7.4750 (0.9); 7.4437 (2.4); 7.4211 (2.5);
7.4043 (3.0); 7.3929 (2.8); 7.3905 (2.3); 7.3753 (1.6); 7.3599 (1.2); 7.2625 (3.0); 7.2221 (1.7); 7.2181
(1.8); 7.2053 (1.5); 7.2013 (1.5); 6.6373 (0.6); 6.6254 (1.2); 6.6135 (0.7); 6.0128 (0.6); 6.0068 (0.6);
5.9984 (0.7); 5.9924 (0.6); 5.9193 (0.6); 5.9133 (0.6); 5.9050 (0.7); 5.8989 (0.6); 5.2963 (1.4); 4.1858
(0.3); 4.1796 (0.3); 4.1726 (0.4); 4.1663 (0.4); 4.1564 (0.4); 4.1502 (0.4); 4.1432 (0.4); 4.1369 (0.4);
4.1308 (0.4); 4.1246 (0.4); 4.1175 (0.4); 4.1113 (0.4); 4.1014 (0.4); 4.0952 (0.4); 4.0881 (0.4); 4.0819
(0.4); 3.8523 (0.4); 3.8407 (0.4); 3.8382 (0.5); 3.8264 (0.4); 3.8231 (0.4); 3.8093 (0.8); 3.7974 (0.8);
3.7835 (0.4); 3.7802 (0.4); 3.7685 (0.4); 3.7659 (0.4); 2.9332 (0.5); 2.8414 (0.5); 2.5753 (16.0);
2.2696 (16.0); −0.0002 (3.4)
I-743: ¹H-NMR(499.9 MHz, CDCl3):
δ = 8.2706 (16.0); 7.8417 (1.8); 7.8314 (1.1); 7.6153 (1.4); 7.6017 (2.5); 7.5883 (1.6); 7.5023 (1.3);
7.4868 (2.8); 7.4720 (1.7); 7.4253 (5.0); 7.4085 (6.2); 7.4032 (4.6); 7.3995 (7.3); 7.3971 (6.9); 7.3812
(3.7); 7.3650 (1.5); 7.2607 (9.8); 7.2377 (3.7); 7.2337 (3.7); 7.2209 (3.1); 7.2169 (3.1); 7.0227 (2.6);
6.9133 (5.4); 6.8040 (2.7); 6.0671 (1.2); 6.0608 (1.3); 6.0533 (1.3); 6.0469 (1.3); 5.9741 (1.2); 5.9677
(1.3); 5.9602 (1.4); 5.9539 (1.3); 5.2977 (0.5); 4.2747 (0.7); 4.2682 (0.7); 4.2614 (0.7); 4.2549 (0.8);
4.2453 (0.8); 4.2389 (0.9); 4.2321 (0.8); 4.2255 (0.9); 4.2220 (0.9); 4.2154 (0.7); 4.2086 (0.8); 4.2021
(0.7); 4.1925 (0.9); 4.1861 (0.8); 4.1793 (0.9); 4.1728 (0.8); 3.8745 (0.8); 3.8639 (0.9); 3.8607 (0.9);
3.8501 (0.8); 3.8452 (0.8); 3.8343 (0.8); 3.8311 (1.6); 3.8205 (1.6); 3.8173 (1.0); 3.8065 (0.8); 3.8016
(0.8); 3.7910 (0.8); 3.7878 (0.8); 3.7772 (0.7); 2.1680 (0.8); 1.5663 (0.5); 1.2563 (0.6); 0.0063
(0.4); −0.0002 (11.3); −0.0066 (0.6)
I-744: ¹H-NMR(499.9 MHz, CDCl3):
δ = 8.2702 (16.0); 7.8522 (1.4); 7.8420 (2.0); 7.6152 (1.8); 7.6015 (2.9); 7.5881 (1.9); 7.5023 (1.7);
7.4868 (3.3); 7.4720 (2.1); 7.4253 (5.8); 7.4085 (7.2); 7.4031 (5.3); 7.3994 (7.9); 7.3971 (7.3); 7.3811
(4.0); 7.3649 (1.7); 7.2608 (9.6); 7.2376 (4.1); 7.2336 (3.9); 7.2209 (3.4); 7.2168 (3.2); 7.0226 (2.8);
6.9132 (5.7); 6.8039 (2.8); 6.0670 (1.4); 6.0607 (1.5); 6.0532 (1.5); 6.0468 (1.4); 5.9740 (1.4); 5.9676
(1.5); 5.9602 (1.5); 5.9538 (1.3); 5.2977 (0.9); 4.2744 (0.9); 4.2679 (0.9); 4.2610 (0.9); 4.2546 (0.9);
4.2450 (1.0); 4.2385 (1.0); 4.2317 (1.0); 4.2252 (1.1); 4.2217 (1.0); 4.2151 (0.9); 4.2083 (0.9); 4.2018
(0.8); 4.1922 (1.0); 4.1857 (0.9); 4.1789 (1.0); 4.1724 (0.9); 3.8743 (1.0); 3.8637 (1.1); 3.8605 (1.1);
3.8499 (1.0); 3.8450 (0.9); 3.8342 (1.0); 3.8309 (1.8); 3.8204 (1.8); 3.8171 (1.2); 3.8063 (1.0); 3.8014
(0.9); 3.7909 (0.9); 3.7876 (0.9); 3.7770 (0.7); 2.1677 (0.8); 1.5616 (1.9); 1.2560 (0.6); 0.0062
(0.6); −0.0002 (10.9); −0.0067 (0.6)
I-745: ¹H-NMR(300.2 MHz, CDCl3):
δ = 7.3336 (5.3); 7.3084 (2.9); 7.2990 (2.9); 7.2822 (3.4); 7.2559 (1.4); 7.1255 (1.6); 7.0999 (1.9);
7.0030 (2.9); 6.9912 (3.7); 6.9857 (5.1); 6.9590 (4.7); 6.9529 (4.4); 6.9164 (3.8); 6.8871 (1.2); 6.8607
(3.1); 6.8353 (1.6); 6.2728 (4.7); 4.5449 (0.5); 4.4271 (5.3); 3.7884 (0.6); 3.7719 (0.6); 3.7524 (0.5);
3.6868 (0.4); 3.4644 (0.7); 3.4517 (16.0); 3.4296 (0.4); 3.4180 (0.3); 3.3846 (0.4); 3.2579 (0.8);
3.2405 (0.5); 3.1947 (15.2); 3.0372 (1.4); 3.0121 (2.7); 2.9870 (1.3); 2.8538 (1.5); 2.8319 (2.6);
2.8100 (1.0); 2.7335 (0.4); 2.6989 (12.6); 2.5472 (14.0); 2.3984 (10.4); 2.3691 (10.4); 2.3324 (0.7);
2.3246 (0.5); 2.3006 (9.9); 2.2582 (0.4); 2.2477 (0.4); 2.0354 (1.8); 1.9649 (11.0); 1.9345 (1.4);
1.9244 (1.0); 1.9183 (0.9); 1.9077 (1.5); 1.8909 (0.8); 1.8805 (0.6); 1.7596 (0.6); 1.0296 (0.7); 1.0146
(2.0); 1.0073 (2.1); 1.0017 (2.8); 0.9941 (2.7); 0.9863 (2.4); 0.9796 (2.7); 0.9735 (2.3); 0.9658 (2.4);
0.9521 (0.9); 0.7650 (0.8); 0.7497 (2.2); 0.7440 (2.1); 0.7337 (2.1); 0.7261 (3.2); 0.7171 (2.3); 0.7065
(2.0); 0.7005 (2.4); 0.6842 (0.7); 0.0410 (2.7)
I-746: ¹H-NMR(300.2 MHz, CDCl3):
δ = 7.4988 (2.1); 7.4721 (2.1); 7.3054 (2.2); 7.2987 (6.9); 7.1361 (0.4); 7.1096 (1.4); 7.0824 (2.4);
7.0732 (1.3); 7.0581 (0.9); 7.0522 (1.1); 7.0313 (0.5); 7.0250 (0.4); 7.0018 (1.1); 6.9751 (1.0); 6.8557
(0.6); 6.8479 (0.6); 6.8327 (1.1); 6.8264 (0.9); 6.8078 (0.6); 6.8019 (0.5); 6.4765 (0.4); 6.4553 (0.8);
6.4346 (0.4); 4.4886 (0.9); 4.4672 (0.8); 4.4417 (1.9); 4.4202 (1.8); 4.3947 (0.9); 4.3732 (0.9); 3.3952
(0.4); 2.4155 (0.4); 2.3946 (16.0); 2.3367 (7.9); 2.1310 (0.4); 2.1200 (0.5); 2.1029 (0.8); 2.0859 (0.5);
2.0747 (0.5); 1.6082 (0.5); 1.3021 (0.6); 1.0809 (0.6); 1.0655 (1.6); 1.0587 (1.8); 1.0440 (1.0); 1.0369
(1.8); 1.0303 (1.6); 1.0158 (0.8); 0.9183 (0.6); 0.8195 (0.8); 0.8044 (2.0); 0.7986 (1.9); 0.7876 (1.7);
0.7819 (2.1); 0.7654 (0.6); 0.0363 (7.8)
I-747: ¹H-NMR(300.2 MHz, CDCl3):
δ = 7.4382 (2.0); 7.4100 (2.4); 7.2991 (9.9); 7.2707 (2.1); 7.1328 (1.2); 7.1149 (1.7); 7.1046 (1.2);
7.0895 (3.2); 7.0821 (1.6); 7.0673 (1.0); 7.0616 (1.3); 7.0406 (0.4); 7.0344 (0.4); 6.8606 (0.7); 6.8523
(0.7); 6.8376 (1.2); 6.8311 (1.1); 6.8127 (0.6); 6.8065 (0.6); 6.5161 (0.5); 6.4954 (0.9); 6.4755 (0.5);
4.2972 (1.0); 4.2759 (0.9); 4.2497 (2.0); 4.2284 (2.0); 4.2021 (1.0); 4.1809 (1.0); 2.5660 (6.6); 2.3811
(16.0); 2.1300 (0.5); 2.1184 (0.6); 2.1017 (1.0); 2.0843 (0.6); 2.0735 (0.6); 1.5998 (4.3); 1.3667 (0.4);
1.3425 (1.0); 1.3022 (6.1); 1.0785 (0.6); 1.0629 (1.8); 1.0563 (2.1); 1.0417 (1.1); 1.0345 (2.0); 1.0279
(1.9); 1.0136 (0.9); 0.9403 (2.1); 0.9189 (6.1); 0.8956 (2.4); 0.8181 (0.9); 0.8025 (2.3); 0.7974 (2.3);
0.7863 (2.0); 0.7803 (2.5); 0.7641 (0.7); 0.0477 (0.4); 0.0370 (12.5)
I-748: ¹H-NMR(300.2 MHz, CDCl3):
δ = 7.4390 (2.2); 7.3718 (1.5); 7.3438 (2.9); 7.2989 (21.1); 7.2607 (0.8); 7.1450 (0.5); 7.1189 (1.6);
7.0927 (3.1); 7.0844 (1.4); 7.0692 (1.0); 7.0639 (1.3); 7.0427 (0.5); 7.0362 (0.4); 6.8634 (0.7); 6.8554
(0.7); 6.8404 (1.3); 6.8335 (1.1); 6.8152 (0.7); 6.8098 (0.6); 6.4741 (0.5); 6.4532 (0.9); 6.4344 (0.5);
4.3006 (1.0); 4.2789 (0.9); 4.2530 (2.1); 4.2318 (2.0); 4.2056 (1.0); 4.1842 (1.0); 2.5652 (6.6); 2.3864
(16.0); 2.1336 (0.5); 2.1219 (0.6); 2.1050 (1.0); 2.0885 (0.6); 2.0769 (0.6); 1.5905 (12.2); 1.3426
(0.5); 1.3025 (3.4); 1.0806 (0.6); 1.0652 (1.9); 1.0585 (2.1); 1.0437 (1.1); 1.0368 (2.0); 1.0303 (2.0);
1.0156 (0.9); 0.9407 (1.1); 0.9191 (3.3); 0.8956 (1.3); 0.8210 (0.8); 0.8058 (2.3); 0.8010 (2.3); 0.7890
(2.0); 0.7835 (2.5); 0.7669 (0.7); 0.0479 (0.9); 0.0370 (26.9); 0.0264 (1.2)
I-749: ¹H-NMR(300.2 MHz, CDCl3):
δ = 7.3188 (2.6); 7.2975 (1.9); 7.2660 (1.6); 7.1740 (1.7); 7.1484 (1.2); 7.1094 (0.4); 7.0803 (1.5);
7.0610 (2.6); 6.8140 (1.4); 6.6368 (1.2); 5.3332 (1.2); 4.2169 (0.8); 4.1990 (0.8); 4.1690 (1.5); 4.1528
(1.4); 4.1246 (0.8); 2.3611 (8.3); 2.2773 (16.0); 2.1089 (0.7); 2.0838 (1.0); 2.0704 (0.9); 1.6555 (1.4);
1.0435 (2.4); 1.0204 (2.3); 0.7810 (3.1); 0.0382 (1.0)
I-750: ¹H-NMR(300.2 MHz, CDCl3):
δ = 7.5529 (0.6); 7.5305 (1.1); 7.5088 (0.7); 7.4286 (0.5); 7.4024 (1.2); 7.3787 (0.9); 7.3656 (2.1);
7.3385 (3.5); 7.3102 (1.6); 7.2993 (1.7); 7.2836 (0.6); 7.0765 (2.4); 7.0703 (2.2); 6.9824 (1.3); 6.9558
(1.1); 6.8861 (2.4); 6.7788 (0.6); 6.7582 (1.1); 6.7376 (0.6); 6.7036 (1.2); 4.2559 (0.9); 4.2349 (0.9);
4.2076 (1.9); 4.1866 (1.8); 4.1592 (1.0); 4.1382 (0.9); 3.1977 (0.4); 2.5160 (6.7); 2.3712 (0.4); 2.3445
(16.0); 2.3168 (9.2); 1.6748 (0.8); 1.3047 (1.2); 0.9425 (0.4); 0.9210 (1.1); 0.8977 (0.4); 0.0396 (1.6)
I-751: ¹H-NMR(300.2 MHz, CDCl3):
δ = 8.2743 (0.3); 7.4116 (3.2); 7.3850 (3.7); 7.2985 (20.5); 7.1257 (1.0); 7.0990 (2.8); 7.0713 (7.4);
7.0628 (5.9); 7.0479 (2.0); 7.0417 (2.3); 7.0209 (0.9); 7.0146 (0.8); 6.9580 (2.0); 6.9311 (1.7); 6.8626
(1.2); 6.8547 (1.2); 6.8396 (2.2); 6.8332 (1.8); 6.8147 (1.1); 6.8088 (1.0); 6.3287 (0.8); 6.3097 (1.5);
6.2891 (0.8); 4.3102 (1.8); 4.2895 (1.7); 4.2624 (3.9); 4.2417 (3.7); 4.2145 (1.9); 4.1938 (1.9); 4.1676
(0.4); 4.1438 (0.4); 2.5285 (10.9); 2.5215 (6.3); 2.3653 (0.4); 2.2952 (14.5); 2.1461 (0.4); 2.1289
(0.8); 2.1179 (0.9); 2.1008 (1.7); 2.0809 (2.5); 2.0729 (1.0); 2.0549 (0.5); 1.5885 (16.0); 1.3201 (0.5);
1.2963 (1.1); 1.2725 (0.5); 1.0795 (1.3); 1.0642 (3.3); 1.0574 (3.6); 1.0514 (2.0); 1.0425 (2.0); 1.0355
(3.5); 1.0290 (3.2); 1.0143 (1.6); 0.8157 (1.8); 0.8006 (4.0); 0.7946 (3.8); 0.7836 (3.5); 0.7781 (4.2);
0.7616 (1.3); 0.1085 (2.8); 0.0494 (0.8); 0.0386 (23.7); 0.0277 (0.9)
I-752: ¹H-NMR(300.2 MHz, CDCl3):
δ = 7.4808 (0.4); 7.4753 (0.4); 7.3814 (0.5); 7.3622 (0.7); 7.3574 (0.7); 7.2991 (11.1); 7.0506 (0.7);
5.3390 (1.4); 5.1214 (0.4); 4.9272 (0.4); 2.2830 (2.8); 1.5879 (16.0); 1.0442 (0.3); 1.0372 (0.4);
1.0102 (0.8); 0.9871 (1.3); 0.9634 (0.6); 0.7933 (0.4); 0.7894 (0.4); 0.7762 (0.4); 0.7718 (0.3); 0.1069
(0.6); 0.0486 (0.4); 0.0377 (10.8); 0.0269 (0.5)
I-753: ¹H-NMR(300.2 MHz, CDCl3):
δ = 7.5073 (0.7); 7.4998 (0.8); 7.4818 (1.2); 7.4762 (1.1); 7.3936 (0.4); 7.3881 (0.4); 7.3769 (1.4);
7.3660 (0.9); 7.3581 (2.0); 7.3526 (2.0); 7.3425 (0.5); 7.2990 (12.3); 7.0725 (0.8); 7.0576 (0.6);
7.0491 (1.8); 7.0357 (0.5); 7.0294 (0.7); 6.8372 (0.3); 6.8155 (0.6); 6.8077 (0.5); 5.3385 (1.5); 5.1689
(0.9); 5.1186 (1.3); 4.9132 (1.2); 4.8629 (0.8); 3.6513 (0.4); 3.6251 (0.9); 3.6035 (0.9); 3.5956 (0.9);
3.5754 (0.9); 3.5697 (0.5); 3.5494 (0.3); 2.2597 (7.9); 2.1420 (0.5); 2.1124 (0.5); 1.6634 (0.3); 1.6414
(0.4); 1.6195 (0.4); 1.5912 (16.0); 1.0446 (0.9); 1.0380 (1.0); 1.0277 (0.5); 1.0225 (0.4); 1.0160 (0.9);
1.0095 (1.0); 0.9947 (0.4); 0.8072 (0.4); 0.7906 (1.0); 0.7865 (0.9); 0.7761 (1.0); 0.7690 (0.7); 0.7565
(0.3); 0.6936 (3.5); 0.6711 (3.4); 0.6460 (3.6); 0.6235 (3.4); 0.1070 (0.6); 0.0485 (0.4); 0.0376 (11.5);
0.0268 (0.5)
I-754: ¹H-NMR(300.2 MHz, CDCl3):
δ = 8.2132 (0.8); 8.1882 (0.8); 8.1198 (5.2); 7.4036 (1.1); 7.3772 (2.5); 7.3509 (1.5); 7.2985 (5.8);
7.1353 (1.8); 7.1097 (2.1); 7.0810 (1.3); 7.0550 (1.1); 6.9429 (0.9); 6.9400 (1.0); 6.9349 (1.3); 6.9318
(1.4); 6.9171 (2.2); 6.9082 (1.2); 6.9053 (1.0); 6.8660 (1.6); 6.8597 (2.1); 6.8528 (1.2); 6.8246 (1.1);
6.7992 (0.9); 5.3362 (13.8); 5.3105 (0.6); 5.2872 (1.6); 5.2625 (1.6); 5.2393 (0.6); 3.3451 (0.3);
3.2978 (1.5); 3.2756 (2.8); 3.2534 (1.5); 3.2291 (0.3); 2.7436 (16.0); 2.3527 (11.2); 2.2455 (10.3);
2.0012 (0.5); 1.9901 (0.6); 1.9849 (0.4); 1.9733 (1.1); 1.9618 (0.4); 1.9565 (0.6); 1.9454 (0.6); 1.6078
(4.6); 1.2974 (0.3); 1.0843 (0.7); 1.0691 (1.8); 1.0623 (2.0); 1.0567 (1.0); 1.0473 (1.1); 1.0407 (2.0);
1.0342 (1.7); 1.0194 (0.9); 0.8004 (0.9); 0.7851 (2.3); 0.7792 (2.0); 0.7687 (1.8); 0.7629 (2.4); 0.7466
(0.7); 0.0389 (7.2)
I-755: ¹H-NMR(400.2 MHz, d₆-DMSO):
δ = 9.3817 (0.4); 9.3665 (0.9); 9.3509 (0.4); 9.0947 (0.8); 9.0797 (1.6); 9.0642 (0.8); 8.3163 (1.0);
7.7524 (0.5); 7.7432 (0.9); 7.7330 (1.4); 7.7239 (2.2); 7.7134 (1.4); 7.7040 (2.2); 7.6928 (8.2); 7.6801
(2.5); 7.6610 (1.6); 7.6400 (0.4); 7.6222 (2.8); 7.5890 (1.6); 7.5619 (2.3); 7.5417 (2.1); 7.3544 (1.2);
7.3344 (1.4); 7.3200 (2.4); 7.3000 (2.7); 7.1054 (1.6); 7.0755 (3.0); 7.0538 (0.4); 6.9622 (0.8); 6.9306
(1.7); 6.9109 (1.5); 4.1837 (0.4); 4.1691 (0.4); 4.1448 (0.9); 4.1315 (1.5); 4.1166 (1.0); 4.0953 (2.1);
4.0797 (1.8); 4.0583 (1.0); 4.0431 (0.9); 3.9842 (2.4); 3.9793 (2.4); 3.9744 (2.4); 3.9528 (2.9); 3.4987
(1.2); 3.4915 (1.3); 3.4709 (2.4); 3.4633 (2.2); 3.4437 (1.3); 3.4351 (1.2); 3.3375 (315.2); 3.3046
(1.8); 3.2868 (0.6); 3.2703 (1.2); 3.2544 (1.4); 3.2415 (0.7); 3.2057 (0.8); 3.1947 (1.0); 3.1783 (1.0);
3.1667 (1.4); 3.1522 (0.8); 3.1400 (0.7); 3.1270 (0.4); 2.7789 (0.4); 2.7614 (0.3); 2.6811 (0.9); 2.6766
(1.3); 2.6722 (1.0); 2.5469 (4.7); 2.5121 (165.2); 2.5076 (217.9); 2.5032 (166.6); 2.4237 (9.6); 2.3836
(1.0); 2.3388 (1.1); 2.3345 (1.4); 2.3299 (1.1); 2.2913 (0.5); 2.2799 (0.5); 2.2471 (6.4); 2.2242 (11.8);
2.1707 (0.6); 2.0777 (16.0); 1.8130 (2.5); 1.8031 (3.3); 1.7884 (2.8); 1.7773 (2.0); 1.7596 (0.9);
1.7551 (0.8); 1.7488 (1.0); 1.7268 (0.4); 1.7164 (0.3); 1.5888 (1.0); 1.5605 (0.9); 1.3987 (0.4)
I-756: ¹H-NMR(300.2 MHz, CDCl3):
δ = 7.4570 (2.6); 7.4290 (3.2); 7.4072 (2.1); 7.4018 (2.8); 7.3968 (2.3); 7.3665 (0.4); 7.2988 (15.9);
7.2015 (1.9); 7.1948 (1.9); 7.1736 (1.6); 7.1669 (1.6); 7.1275 (1.1); 7.1162 (0.8); 7.1000 (3.2); 7.0946
(2.3); 7.0809 (4.1); 7.0663 (1.9); 7.0469 (0.5); 6.8417 (0.8); 6.8275 (0.9); 6.8200 (1.1); 6.8111 (1.3);
6.7956 (0.8); 6.7878 (0.7); 6.0895 (0.6); 6.0788 (0.6); 6.0672 (0.7); 6.0563 (0.6); 5.9348 (0.6); 5.9242
(0.6); 5.9125 (0.7); 5.9017 (0.6); 4.2573 (0.3); 4.2465 (0.3); 4.2355 (0.3); 4.2247 (0.3); 4.2085 (0.4);
4.1972 (0.5); 4.1867 (0.4); 4.1714 (0.9); 4.1597 (0.4); 4.1482 (0.8); 4.1377 (0.3); 4.1222 (0.5); 4.1110
(0.4); 4.0997 (0.4); 4.0888 (0.4); 3.8930 (0.4); 3.8750 (0.5); 3.8709 (0.5); 3.8528 (0.4); 3.8445 (0.4);
3.8177 (0.6); 3.7994 (0.6); 3.7773 (0.5); 3.7688 (0.4); 3.7506 (0.4); 3.7463 (0.4); 3.1000 (0.5); 3.0902
(0.7); 3.0774 (1.0); 3.0684 (1.0); 3.0558 (0.8); 3.0458 (0.5); 2.1479 (0.6); 2.1371 (0.6); 2.1198 (1.2);
2.1028 (0.7); 2.0918 (0.7); 2.0828 (2.4); 1.5906 (16.0); 1.3453 (0.4); 1.3211 (1.3); 1.3050 (2.6);
1.2975 (3.2); 1.2736 (0.8); 1.0774 (0.8); 1.0620 (2.2); 1.0553 (2.5); 1.0406 (1.3); 1.0335 (2.4); 1.0269
(2.2); 1.0124 (1.1); 0.9422 (1.0); 0.9204 (3.0); 0.9078 (0.7); 0.8964 (2.6); 0.8893 (2.4); 0.8661 (2.4);
0.8546 (0.8); 0.8474 (0.7); 0.8224 (1.2); 0.8073 (2.8); 0.8014 (2.8); 0.7904 (2.6); 0.7848 (3.0); 0.7684
(1.0); 0.7291 (0.8); 0.7133 (2.5); 0.7053 (2.4); 0.7009 (2.4); 0.6935 (1.8); 0.6777 (0.6); 0.0490 (0.6);
0.0383 (20.0); 0.0273 (0.8)
I-757: ¹H-NMR(300.2 MHz, CDCl3):
δ = 7.3427 (3.9); 7.3357 (4.2); 7.2990 (14.6); 7.2023 (3.2); 7.1750 (4.0); 7.1203 (0.8); 7.0934 (2.2);
7.0663 (3.2); 7.0554 (2.1); 7.0398 (1.5); 7.0340 (1.9); 7.0129 (0.8); 7.0069 (0.7); 6.9948 (2.5); 6.9878
(2.4); 6.9675 (2.0); 6.9604 (1.9); 6.9010 (0.8); 6.8354 (1.0); 6.8277 (1.0); 6.8121 (1.8); 6.8064 (1.5);
6.7873 (0.9); 6.7816 (0.9); 3.8190 (1.4); 3.7973 (3.8); 3.7762 (3.9); 3.7546 (1.6); 3.1963 (9.9); 3.1781
(9.9); 3.0943 (2.9); 3.0721 (5.4); 3.0498 (2.6); 2.1253 (0.7); 2.1140 (0.8); 2.0968 (1.4); 2.0823 (1.4);
2.0688 (0.8); 2.0515 (0.4); 1.5935 (16.0); 1.3211 (0.4); 1.3046 (0.9); 1.2975 (1.0); 1.0750 (1.0);
1.0596 (2.6); 1.0529 (2.9); 1.0382 (1.6); 1.0310 (2.9); 1.0245 (2.7); 1.0100 (1.3); 0.9204 (0.9); 0.8973
(0.3); 0.8174 (1.3); 0.8021 (3.2); 0.7964 (3.2); 0.7853 (2.9); 0.7795 (3.5); 0.7633 (1.0); 0.0492 (0.6);
0.0384 (18.0); 0.0275 (0.8)
I-758: ¹H-NMR(300.2 MHz, d₆-DMSO):
δ = 9.3152 (0.5); 7.6629 (0.6); 7.6600 (0.6); 7.6567 (0.6); 7.6147 (0.7); 7.5866 (0.9); 7.3842 (0.5);
7.3773 (0.5); 7.3562 (0.4); 7.3493 (0.4); 7.1829 (0.5); 7.1563 (0.4); 7.1205 (0.3); 7.0971 (0.4); 6.9606
(0.4); 6.4762 (0.4); 6.4591 (0.4); 4.0386 (0.4); 3.3406 (16.0); 2.5348 (0.8); 2.5288 (1.6); 2.5227 (2.4);
2.5167 (1.7); 2.5107 (0.8); 2.0906 (0.4); 2.0098 (1.4); 1.2195 (0.4); 1.1958 (0.7); 1.1721 (0.4); 1.0599
(0.6); 1.0526 (0.6); 1.0392 (0.4); 1.0318 (0.6); 1.0245 (0.6); 0.8122 (0.6); 0.8059 (0.7); 0.7955 (0.6);
0.7889 (0.7); 0.0206 (0.8)
I-759: ¹H-NMR(300.2 MHz, d₆-DMSO):
δ = 9.0413 (0.4); 9.0222 (0.9); 9.0032 (0.4); 7.5524 (1.8); 7.5452 (1.8); 7.4393 (1.4); 7.4117 (1.7);
7.2161 (1.1); 7.2088 (1.4); 7.1886 (1.0); 7.1812 (1.8); 7.1529 (0.9); 7.1174 (0.5); 7.1116 (0.6); 7.0882
(0.8); 7.0663 (0.4); 6.9859 (0.4); 6.9802 (0.4); 6.9600 (0.8); 6.9375 (0.4); 6.9324 (0.3); 3.6318 (0.4);
3.6093 (1.2); 3.5892 (1.2); 3.5670 (0.5); 3.3403 (16.0); 3.0171 (0.8); 2.9944 (1.8); 2.9714 (0.8);
2.5345 (1.2); 2.5286 (2.7); 2.5226 (3.8); 2.5165 (2.8); 2.5107 (1.3); 2.1136 (0.3); 2.1027 (0.4); 2.0861
(0.6); 2.0684 (0.4); 2.0576 (0.4); 1.0738 (0.4); 1.0589 (1.1); 1.0517 (1.2); 1.0381 (0.7); 1.0309 (1.1);
1.0236 (1.2); 1.0103 (0.5); 0.8253 (0.5); 0.8115 (1.2); 0.8052 (1.4); 0.7947 (1.3); 0.7881 (1.4); 0.7727
(0.4); 0.0204 (2.7)
I-760: ¹H-NMR(300.2 MHz, CDCl3):
δ = 8.8868 (1.2); 7.8429 (1.0); 7.3560 (2.1); 7.3294 (2.4); 7.2987 (9.4); 7.1009 (0.6); 7.0732 (1.8);
7.0491 (3.5); 7.0260 (4.0); 7.0057 (0.7); 6.9993 (0.5); 6.9200 (1.4); 6.8946 (1.3); 6.8164 (0.8); 6.8073
(0.8); 6.7940 (1.5); 6.7871 (1.2); 6.7689 (0.8); 6.7629 (0.7); 4.2199 (1.2); 4.2001 (1.2); 4.1727 (2.4);
4.1529 (2.3); 4.1253 (1.2); 4.1057 (1.2); 3.0162 (0.5); 3.0061 (0.8); 2.9942 (1.1); 2.9836 (1.1); 2.9717
(0.8); 2.9609 (0.5); 2.8431 (16.0); 2.4899 (7.6); 2.2909 (10.4); 2.1493 (0.6); 2.1380 (0.7); 2.1209
(1.2); 2.1037 (0.7); 2.0929 (0.7); 2.0752 (0.4); 1.6164 (6.7); 1.0681 (0.8); 1.0525 (2.3); 1.0460 (2.4);
1.0313 (1.4); 1.0242 (2.3); 1.0177 (2.2); 1.0033 (1.0); 0.9082 (0.6); 0.8853 (2.6); 0.8679 (2.7); 0.8455
(1.0); 0.8164 (1.2); 0.8011 (2.8); 0.7959 (2.8); 0.7845 (2.6); 0.7791 (2.9); 0.7626 (0.9); 0.7269 (1.0);
0.7115 (2.5); 0.7034 (2.8); 0.6748 (0.6); 0.1081 (1.0); 0.0381 (8.4)
I-761: ¹H-NMR(300.2 MHz, CDCl3):
δ = 7.4636 (4.2); 7.4356 (5.4); 7.4136 (4.6); 7.3651 (0.3); 7.3416 (0.4); 7.3343 (0.4); 7.2988 (18.2);
7.2373 (4.0); 7.2307 (4.0); 7.2095 (3.1); 7.2027 (2.9); 7.1219 (0.6); 7.0951 (6.7); 7.0769 (5.4); 7.0679
(3.4); 7.0495 (0.8); 6.8342 (1.3); 6.8178 (1.8); 6.8128 (1.6); 6.8029 (2.1); 6.7889 (1.2); 6.7802 (1.1);
6.0903 (0.9); 6.0799 (1.0); 6.0682 (1.0); 6.0576 (0.9); 5.9357 (0.9); 5.9250 (1.0); 5.9134 (1.0); 5.9031
(1.0); 5.3368 (16.0); 4.2428 (0.4); 4.2322 (0.4); 4.2216 (0.4); 4.2111 (0.4); 4.1944 (0.9); 4.1831 (0.6);
4.1708 (1.6); 4.1605 (0.7); 4.1468 (1.4); 4.1353 (0.5); 4.1234 (0.8); 4.1075 (0.6); 4.0967 (0.6); 4.0863
(0.6); 4.0752 (0.5); 3.9269 (0.6); 3.9061 (0.9); 3.8855 (0.6); 3.8779 (0.5); 3.8515 (0.8); 3.8306 (1.0);
3.8097 (0.6); 3.8024 (0.6); 3.7812 (0.7); 3.7604 (0.5); 3.1979 (10.0); 3.1797 (10.0); 2.1609 (0.4);
2.1438 (1.0); 2.1327 (1.0); 2.1155 (2.0); 2.0981 (1.2); 2.0821 (5.0); 2.0702 (0.6); 1.5990 (11.2);
1.3681 (0.4); 1.3442 (1.0); 1.3204 (2.9); 1.3045 (6.5); 1.2969 (7.4); 1.2729 (1.7); 1.0732 (1.3); 1.0577
(3.7); 1.0510 (3.9); 1.0365 (2.1); 1.0292 (3.8); 1.0226 (3.7); 1.0083 (1.7); 0.9416 (2.3); 0.9199 (7.3);
0.8966 (2.7); 0.8164 (1.7); 0.8011 (4.4); 0.7958 (4.3); 0.7845 (3.9); 0.7785 (4.7); 0.7625 (1.3); 0.0487
(0.6); 0.0380 (20.4); 0.0270 (0.8)
I-762: ¹H-NMR(300.2 MHz, CDCl3):
δ = 8.3205 (9.7); 8.1422 (0.7); 8.1239 (1.0); 7.3387 (2.2); 7.3119 (2.7); 7.2988 (10.6); 7.1927 (0.4);
7.1663 (5.6); 7.1523 (2.9); 7.1486 (4.3); 7.1430 (3.1); 7.1401 (2.9); 7.1217 (0.7); 7.0244 (6.0); 6.9994
(1.7); 6.9240 (1.1); 6.9061 (1.3); 6.9024 (1.3); 6.8926 (1.8); 6.8791 (0.9); 6.8701 (0.8); 6.0094 (0.7);
5.9994 (0.8); 5.9824 (0.8); 5.9725 (0.8); 5.8511 (0.7); 5.8411 (0.8); 5.8242 (0.8); 5.8143 (0.7); 4.2659
(0.4); 4.2560 (0.4); 4.2427 (0.4); 4.2326 (0.5); 4.2172 (0.5); 4.2071 (0.5); 4.1948 (0.6); 4.1840 (0.6);
4.1723 (0.8); 4.1672 (0.5); 4.1568 (0.4); 4.1485 (0.8); 4.1440 (0.6); 4.1335 (0.4); 4.1248 (0.4); 4.1183
(0.6); 4.1083 (0.5); 4.0952 (0.6); 4.0850 (0.5); 3.7861 (0.5); 3.7701 (0.5); 3.7591 (0.5); 3.7431 (0.6);
3.7377 (0.5); 3.7237 (0.7); 3.7093 (0.9); 3.6956 (0.7); 3.6815 (0.6); 3.6760 (0.5); 3.6599 (0.4); 3.6488
(0.4); 3.6329 (0.4); 2.4079 (16.0); 2.3649 (0.4); 2.3137 (13.8); 2.1909 (0.4); 2.1732 (0.8); 2.1622
(0.8); 2.1449 (1.5); 2.1276 (0.9); 2.1166 (0.8); 2.0994 (0.5); 2.0836 (3.4); 1.5999 (7.9); 1.3218 (1.0);
1.2979 (2.3); 1.2742 (0.9); 1.1100 (1.0); 1.0946 (2.8); 1.0879 (3.0); 1.0731 (1.6); 1.0661 (3.0); 1.0595
(2.8); 1.0449 (1.3); 0.8492 (1.4); 0.8340 (3.4); 0.8282 (3.3); 0.8171 (3.0); 0.8114 (3.6); 0.7951 (1.0);
0.1096 (0.4); 0.0500 (0.4); 0.0391 (12.6); 0.0281 (0.5)
I-763: ¹H-NMR(300.2 MHz, CDCl3):
δ = 7.5752 (1.4); 7.5559 (3.8); 7.5528 (3.8); 7.5364 (0.3); 7.5054 (1.8); 7.4546 (0.8); 7.4441 (1.1);
7.4370 (0.9); 7.4242 (0.7); 7.4163 (0.4); 7.3166 (1.4); 7.2988 (4.2); 7.2890 (1.7); 7.0637 (1.3); 7.0400
(3.4); 6.6516 (0.5); 6.6318 (0.7); 6.6126 (0.5); 5.9825 (0.4); 5.9728 (0.5); 5.9552 (0.5); 5.9454 (0.4);
5.8239 (0.4); 5.8141 (0.5); 5.7965 (0.5); 5.7868 (0.4); 4.1807 (0.3); 4.1707 (0.3); 4.1568 (0.3); 4.1468
(0.3); 4.0811 (0.3); 4.0572 (0.3); 3.7291 (0.4); 3.7248 (0.3); 3.7126 (0.4); 3.7083 (0.3); 3.6965 (0.6);
3.6851 (0.4); 3.6807 (0.3); 3.6684 (0.4); 3.6642 (0.3); 2.4463 (16.0); 2.3960 (9.6); 2.3401 (8.4);
2.0768 (0.5); 1.6204 (2.3); 1.2944 (1.3); 0.0394 (4.3)
I-764: ¹H-NMR(400.1 MHz, d₆-DMSO):
δ = 9.2521 (1.3); 9.2370 (2.4); 9.2220 (1.2); 8.0951 (0.4); 8.0066 (12.0); 7.9595 (0.8); 7.7079 (0.6);
7.5238 (1.4); 7.5060 (2.4); 7.4879 (1.5); 7.4684 (1.1); 7.4486 (2.2); 7.4310 (1.6); 7.3706 (2.4); 7.3511
(3.1); 7.3318 (4.6); 7.3120 (3.8); 7.1440 (0.3); 7.0766 (4.4); 6.9463 (2.3); 6.9275 (2.1); 4.1322 (1.3);
4.1178 (1.3); 4.0954 (2.7); 4.0804 (2.6); 4.0581 (1.4); 4.0437 (1.3); 3.3137 (694.9); 3.2909 (3.0);
3.2711 (0.8); 3.2622 (0.6); 2.8976 (5.6); 2.7384 (4.8); 2.6767 (0.3); 2.5119 (43.9); 2.5075 (57.3);
2.5032 (42.2); 2.4275 (11.8); 2.3298 (0.5); 2.3113 (0.9); 2.2725 (0.9); 2.2451 (0.3); 2.2011 (16.0);
2.1801 (0.9); 1.4887 (0.9); 1.4696 (3.1); 1.4531 (1.2); 1.4415 (1.0); 1.4220 (3.0); 1.4056 (1.2); 1.2012
(1.2); 1.1804 (3.8); 1.1624 (3.9); 1.1413 (0.9)
I-765: ¹H-NMR(400.1 MHz, d₆-DMSO):
δ = 9.1683 (1.6); 9.1540 (3.1); 9.1385 (1.5); 8.0934 (15.9); 7.9592 (2.4); 7.6457 (5.3); 7.5793 (5.3);
7.5583 (6.5); 7.5241 (1.5); 7.5049 (2.8); 7.4888 (2.9); 7.4724 (3.0); 7.4541 (1.9); 7.4032 (3.8); 7.3981
(3.7); 7.3822 (3.3); 7.3769 (3.4); 7.3713 (3.0); 7.3512 (3.6); 7.3312 (1.5); 6.0759 (1.1); 6.0646 (1.7);
6.0510 (1.1); 5.9603 (1.0); 5.9498 (1.7); 5.9354 (1.2); 3.9368 (0.4); 3.9153 (1.0); 3.8995 (2.6); 3.8854
(2.3); 3.8747 (1.3); 3.8590 (1.2); 3.8429 (2.2); 3.8287 (2.1); 3.8149 (1.0); 3.8038 (0.4); 3.7937 (0.3);
3.4380 (0.6); 3.3514 (3.6); 3.3133 (786.0); 3.2693 (0.7); 2.8976 (16.0); 2.7386 (13.7); 2.6762 (0.4);
2.5120 (48.7); 2.5075 (64.1); 2.5031 (46.6); 2.3344 (0.4); 2.3293 (0.3); 1.4865 (1.1); 1.4678 (3.7);
1.4511 (1.5); 1.4405 (1.2); 1.4201 (3.8); 1.4044 (1.5); 1.2048 (1.5); 1.1839 (4.6); 1.1663 (4.7); 1.1452 (1.0)
I-766: ¹H-NMR(400.1 MHz, d₆-DMSO):
δ = 9.3715 (0.7); 9.3555 (1.5); 9.3401 (0.7); 7.9591 (1.3); 7.5044 (0.7); 7.4861 (1.2); 7.4699 (0.8);
7.4093 (0.6); 7.3894 (1.3); 7.3720 (1.0); 7.3443 (2.5); 7.3244 (2.7); 7.3098 (0.6); 7.0999 (2.6); 6.9864
(1.4); 6.9672 (1.2); 4.1728 (0.7); 4.1575 (0.7); 4.1355 (1.4); 4.1199 (1.4); 4.0977 (0.8); 4.0823 (0.7);
3.3562 (0.7); 3.3152 (168.3); 3.2777 (0.4); 2.8974 (8.8); 2.7385 (7.6); 2.5120 (10.0); 2.5075 (13.1);
2.5032 (9.7); 2.4443 (6.9); 2.4126 (0.6); 2.2283 (10.9); 2.2217 (16.0); 1.4811 (0.5); 1.4613 (1.8);
1.4449 (0.7); 1.4341 (0.6); 1.4140 (1.8); 1.3983 (0.7); 1.3615 (0.7); 1.3459 (0.7); 1.1944 (0.7); 1.1739
(2.2); 1.1560 (2.2); 1.1347 (0.5)
I-767: ¹H-NMR(300.2 MHz, CDCl3):
δ = 8.1663 (1.0); 8.1591 (5.6); 7.9894 (0.4); 7.9719 (0.7); 7.9534 (0.4); 7.6621 (0.5); 7.6512 (1.5);
7.6427 (1.5); 7.6321 (3.7); 7.6291 (3.4); 7.6109 (0.8); 7.5828 (0.4); 7.5169 (0.3); 7.4962 (1.9); 7.4687
(0.7); 7.4584 (1.1); 7.4511 (0.8); 7.4380 (0.8); 7.4303 (0.4); 7.3655 (1.7); 7.3389 (1.9); 7.2987 (8.8);
7.0669 (1.8); 6.9767 (1.0); 6.9496 (0.9); 4.3018 (0.9); 4.2820 (0.9); 4.2538 (2.0); 4.2341 (1.9); 4.2059
(1.0); 4.1861 (1.0); 2.6899 (16.0); 2.5152 (3.1); 2.5085 (5.6); 2.5012 (3.1); 2.3133 (7.6); 2.0443 (1.2);
1.5964 (1.9); 0.1088 (0.7); 0.0492 (0.4); 0.0385 (10.7); 0.0276 (0.3)
I-768: ¹H-NMR(300.2 MHz, CDCl3):
δ = 8.1186 (10.4); 7.9810 (0.9); 7.9631 (1.6); 7.9447 (0.9); 7.8975 (0.9); 7.6767 (0.5); 7.6502 (2.8);
7.6300 (7.7); 7.5591 (0.4); 7.4957 (3.9); 7.4685 (1.7); 7.4591 (2.5); 7.4517 (1.7); 7.4380 (1.7); 7.4310
(1.0); 7.3628 (3.4); 7.3362 (3.9); 7.2987 (12.0); 7.0659 (4.0); 6.9746 (2.2); 6.9482 (2.0); 4.2980 (1.8);
4.2784 (1.8); 4.2501 (3.9); 4.2304 (3.8); 4.2022 (2.0); 4.1824 (1.9); 3.4596 (0.7); 3.4360 (1.0); 3.4127
(0.8); 3.3472 (2.3); 3.3227 (7.1); 3.2982 (7.2); 3.2738 (2.4); 2.5068 (11.8); 2.3127 (16.0); 1.7694
(1.0); 1.5286 (0.7); 1.5045 (1.8); 1.4809 (1.8); 1.4562 (1.1); 1.4448 (7.7); 1.4204 (15.6); 1.3959 (7.2);
1.2927 (0.9); 0.1084 (1.8); 0.0378 (14.0); 0.0271 (0.6)
I-769: ¹H-NMR(499.9 MHz, d₆-DMSO):
δ = 11.2190 (2.6); 9.1755 (1.2); 9.1630 (2.6); 9.1504 (1.3); 7.8885 (12.4); 7.4595 (3.9); 7.4421 (4.2);
7.4328 (2.9); 7.4273 (4.6); 7.4218 (3.0); 7.3558 (4.5); 7.3512 (5.0); 7.3473 (4.2); 7.3312 (4.2); 7.0871
(4.3); 6.9784 (2.2); 6.9624 (2.1); 6.9489 (3.0); 6.9443 (3.1); 6.9315 (2.8); 6.9269 (2.9); 6.4687 (2.3);
6.4647 (3.6); 6.4604 (2.5); 4.1247 (1.1); 4.1123 (1.1); 4.0951 (2.6); 4.0825 (2.6); 4.0652 (1.3); 4.0547
(1.5); 4.0408 (2.0); 4.0266 (2.0); 4.0123 (0.7); 3.3237 (8.5); 2.5118 (1.8); 2.5082 (3.8); 2.5046 (5.2);
2.5010 (3.9); 2.4975 (1.9); 2.4278 (11.0); 2.3566 (0.6); 2.3525 (0.4); 2.2873 (0.8); 2.2708 (0.4);
2.2292 (16.0); 2.1853 (0.4); 1.9923 (8.2); 1.2479 (0.7); 1.1928 (2.2); 1.1785 (4.4); 1.1643 (2.2);
0.8755 (0.4); 0.8618 (1.3); 0.8476 (0.6)
I-770: ¹H-NMR(300.2 MHz, CDCl3):
δ = 8.3022 (16.0); 8.0327 (1.0); 8.0149 (1.7); 7.9965 (1.0); 7.5895 (6.1); 7.5398 (0.3); 7.5328 (1.0);
7.5284 (1.0); 7.5103 (9.4); 7.5029 (4.2); 7.4865 (5.7); 7.4609 (1.6); 7.4246 (1.5); 7.4190 (1.2); 7.3967
(6.3); 7.3912 (6.6); 7.3804 (12.5); 7.3691 (4.0); 7.3529 (2.0); 7.2988 (14.3); 7.2635 (2.3); 7.2558
(3.7); 7.2475 (1.9); 7.2397 (2.0); 7.2323 (3.4); 7.2244 (1.7); 6.1186 (1.3); 6.1080 (1.4); 6.0954 (1.4);
6.0847 (1.3); 5.9635 (1.3); 5.9528 (1.4); 5.9402 (1.4); 5.9295 (1.3); 4.3426 (0.7); 4.3318 (0.7); 4.3204
(0.7); 4.3095 (0.7); 4.2939 (0.9); 4.2831 (0.9); 4.2716 (0.9); 4.2608 (0.9); 4.2541 (0.8); 4.2432 (0.7);
4.2318 (0.8); 4.2209 (0.7); 4.2052 (0.9); 4.1944 (0.9); 4.1830 (0.9); 4.1721 (0.8); 3.9048 (0.9); 3.8876
(0.9); 3.8814 (0.9); 3.8643 (1.0); 3.8560 (0.8); 3.8387 (0.8); 3.8328 (1.7); 3.8157 (1.6); 3.8097 (1.0);
3.7925 (0.9); 3.7842 (0.8); 3.7670 (0.8); 3.7608 (0.7); 3.7437 (0.6); 3.1928 (13.9); 2.0436 (5.4);
1.6251 (1.0); 0.0477 (0.6); 0.0369 (17.8); 0.0258 (0.6)
I-771: ¹H-NMR(400.1 MHz, CDCl3):
δ = 8.8161 (9.5); 7.8647 (1.0); 7.8514 (1.7); 7.8377 (1.0); 7.6812 (0.4); 7.6607 (3.3); 7.6534 (3.0);
7.6469 (7.3); 7.5220 (3.7); 7.4871 (0.4); 7.4761 (1.4); 7.4672 (1.9); 7.4621 (1.8); 7.4535 (1.6); 7.4475
(1.1); 7.3423 (3.4); 7.3223 (3.8); 7.2640 (5.5); 7.0448 (4.1); 6.9504 (2.2); 6.9304 (2.1); 5.3003 (4.8);
4.2941 (1.0); 4.2792 (1.0); 4.2685 (0.8); 4.2580 (1.6); 4.2434 (1.5); 4.2316 (1.5); 4.2173 (1.6); 4.2063
(0.9); 4.1955 (1.2); 4.1809 (1.1); 3.3074 (0.4); 3.2888 (1.3); 3.2705 (1.6); 3.2547 (2.0); 3.2363 (1.9);
3.2179 (0.6); 3.0999 (0.5); 3.0815 (1.8); 3.0632 (2.1); 3.0473 (1.7); 3.0291 (1.4); 3.0108 (0.5); 2.4800
(11.5); 2.2846 (16.0); 1.6294 (6.7); 1.2720 (6.5); 1.2536 (14.7); 1.2351 (6.5); 0.0723 (0.8); −0.0002 (6.4)
I-772: ¹H-NMR(400.1 MHz, CDCl3):
δ = 9.8529 (0.6); 9.8259 (0.6); 8.1621 (5.4); 7.5911 (0.8); 7.5716 (2.3); 7.5611 (1.8); 7.5415 (1.9);
7.5219 (0.7); 7.2763 (3.1); 7.2613 (2.5); 7.2527 (1.7); 7.2487 (1.6); 7.2254 (1.4); 7.1906 (1.2); 7.1712
(1.2); 7.1167 (2.1); 7.0975 (2.2); 6.8899 (2.7); 6.4403 (1.4); 6.4213 (1.3); 6.0176 (1.8); 5.9945 (1.8);
2.7211 (16.0); 2.6921 (0.8); 2.6760 (0.6); 2.2888 (0.4); 2.2759 (0.6); 2.2552 (0.8); 2.2173 (12.8);
2.1294 (0.5); 2.0565 (0.6); 2.0417 (12.0); 1.9411 (0.5); 1.6328 (0.8); −0.0002 (2.9)
I-773: ¹H-NMR(300.2 MHz, CDCl3):
δ = 7.3199 (1.6); 7.2984 (3.4); 7.1237 (0.4); 7.1058 (2.5); 7.0991 (2.0); 7.0967 (2.0); 7.0933 (1.8);
7.0806 (3.5); 7.0658 (0.4); 7.0517 (1.4); 7.0242 (3.5); 6.8437 (0.7); 6.8348 (0.6); 6.8216 (1.2); 6.8102
(0.9); 6.8035 (0.6); 6.7898 (0.5); 6.6951 (0.5); 6.6759 (0.8); 6.6564 (0.5); 5.9806 (0.4); 5.9706 (0.5);
5.9536 (0.5); 5.9435 (0.5); 5.8222 (0.4); 5.8122 (0.5); 5.7952 (0.5); 5.7851 (0.5); 5.3341 (0.4); 4.1631
(0.4); 4.1587 (0.4); 4.1481 (0.4); 4.1394 (0.4); 4.1352 (0.4); 4.1244 (0.3); 4.0599 (0.4); 4.0495 (0.3);
4.0363 (0.3); 3.7717 (0.3); 3.7616 (0.3); 3.7444 (0.4); 3.7404 (0.4); 3.7284 (0.4); 3.7234 (0.3); 3.7121
(0.6); 3.7012 (0.4); 3.6962 (0.4); 3.6842 (0.4); 3.6801 (0.4); 2.4573 (16.0); 2.3990 (10.1); 2.3306
(8.7); 2.1238 (0.6); 2.1129 (0.6); 2.0956 (1.0); 2.0782 (2.2); 2.0673 (0.6); 1.6567 (0.8); 1.3183 (0.4);
1.2945 (1.2); 1.2707 (0.4); 1.0632 (0.7); 1.0478 (1.8); 1.0411 (2.0); 1.0264 (1.1); 1.0193 (1.9); 1.0128
(1.8); 0.9982 (0.9); 0.8059 (0.9); 0.7908 (2.2); 0.7852 (2.2); 0.7739 (2.0); 0.7684 (2.3); 0.7519 (0.7);
0.0394 (2.2)
I-774: ¹H-NMR(300.2 MHz, CDCl3):
δ = 7.5712 (1.5); 7.5521 (3.9); 7.5494 (3.8); 7.4754 (1.8); 7.4363 (0.8); 7.4253 (1.1); 7.4181 (1.0);
7.4056 (0.8); 7.3956 (2.1); 7.3685 (2.0); 7.2985 (11.4); 7.0955 (2.0); 7.0198 (1.1); 6.9930 (1.0);
6.3840 (0.5); 6.3634 (0.9); 6.3427 (0.5); 4.2907 (1.0); 4.2699 (0.9); 4.2420 (2.0); 4.2211 (1.9); 4.1933
(1.0); 4.1722 (1.0); 2.5303 (6.0); 2.4099 (16.0); 2.3373 (8.2); 2.0806 (0.3); 1.5896 (14.8); 1.2953
(0.4); 0.0485 (0.4); 0.0378 (13.7); 0.0269 (0.5)
I-775: ¹H-NMR(400.1 MHz, CDCl3):
δ = 8.0176 (2.7); 7.6071 (0.8); 7.3360 (1.9); 7.3161 (2.2); 7.2632 (15.1); 7.0530 (0.5); 7.0325 (1.9);
7.0235 (1.3); 7.0154 (3.9); 7.0029 (3.8); 6.9874 (0.6); 6.9142 (1.3); 6.8949 (1.2); 6.7628 (0.6); 6.7544
(0.7); 6.7464 (1.2); 6.7404 (1.1); 6.7272 (0.7); 6.7228 (0.7); 4.1908 (0.9); 4.1756 (0.9); 4.1548 (2.0);
4.1397 (2.0); 4.1186 (1.0); 4.1036 (1.0); 3.1055 (6.7); 3.0917 (6.8); 2.9587 (16.0); 2.8855 (15.0);
2.6415 (13.2); 2.4683 (6.7); 2.2674 (9.4); 2.1015 (0.5); 2.0933 (0.6); 2.0804 (1.1); 2.0673 (0.7);
2.0592 (0.6); 2.0459 (0.4); 1.6031 (3.9); 1.0176 (0.6); 1.0058 (1.9); 1.0011 (2.1); 0.9899 (1.1); 0.9846
(2.1); 0.9800 (2.0); 0.9690 (0.9); 0.7674 (0.8); 0.7556 (2.4); 0.7523 (2.4); 0.7431 (2.3); 0.7393 (2.6);
0.7271 (0.8); −0.0002 (1.4)
I-776: ¹H-NMR(400.1 MHz, CDCl3):
δ = 8.4875 (0.6); 8.0183 (2.9); 7.7654 (1.1); 7.4201 (2.4); 7.3991 (2.8); 7.3703 (3.4); 7.2635 (15.2);
7.1796 (1.9); 7.1585 (1.7); 7.0752 (0.4); 7.0541 (3.2); 7.0400 (4.1); 7.0168 (0.6); 6.7797 (0.8); 6.7664
(1.4); 6.7567 (1.5); 6.7448 (0.9); 6.0433 (0.6); 6.0348 (0.7); 6.0281 (0.7); 6.0204 (0.7); 5.9274 (0.6);
5.9193 (0.7); 5.9127 (0.8); 5.9041 (0.7); 4.1452 (0.3); 4.1247 (0.4); 4.1164 (0.4); 4.1089 (0.4); 4.1007
(0.7); 4.0913 (0.4); 4.0845 (0.4); 4.0765 (0.4); 4.0637 (0.4); 4.0549 (0.4); 4.0479 (0.4); 4.0403 (0.4);
3.8779 (0.3); 3.8630 (0.6); 3.8480 (0.4); 3.8258 (0.6); 3.8176 (0.5); 3.8034 (0.7); 3.7888 (0.4); 3.7823
(0.4); 3.7667 (0.6); 3.7524 (0.3); 3.1731 (0.4); 3.1568 (7.8); 3.1432 (7.8); 2.9594 (16.0); 2.8862
(15.8); 2.6783 (15.2); 2.3820 (0.7); 2.1091 (0.6); 2.0999 (0.8); 2.0882 (1.3); 2.0764 (0.9); 2.0673
(0.8); 2.0542 (0.4); 1.6002 (9.3); 1.0240 (0.7); 1.0077 (2.7); 0.9899 (2.8); 0.9763 (1.1); 0.7743 (0.8);
0.7612 (3.4); 0.7479 (3.4); 0.7344 (1.0); −0.0002 (1.4)
I-777: ¹H-NMR(400.1 MHz, CDCl3):
δ = 7.9912 (1.0); 7.5633 (0.4); 7.5435 (1.6); 7.5275 (4.4); 7.4064 (2.2); 7.3526 (0.8); 7.3460 (1.3);
7.3404 (1.0); 7.3299 (1.1); 7.2627 (14.3); 6.7145 (3.8); 6.1414 (0.9); 6.1291 (0.6); 3.7943 (1.0);
3.7782 (2.8); 3.7626 (2.9); 3.7466 (1.3); 2.9530 (6.8); 2.8728 (6.6); 2.8666 (2.4); 2.8494 (3.6); 2.8329
(1.9); 2.4125 (16.0); 2.3530 (0.4); 2.3324 (0.8); 2.2914 (12.0); 2.2430 (0.4); 2.1709 (0.4); 2.0445
(12.0); 1.9211 (0.4); 1.5877 (5.0); −0.0002 (1.3)
I-778: ¹H-NMR(400.1 MHz, CDCl3):
δ = 8.0101 (0.7); 7.5649 (0.6); 7.5459 (1.7); 7.5263 (4.1); 7.4948 (2.9); 7.4585 (1.9); 7.4392 (1.3);
7.4158 (0.4); 7.4120 (0.3); 7.2950 (0.4); 7.2622 (54.2); 6.9981 (0.4); 6.4333 (3.3); 6.2549 (1.0);
6.2337 (1.1); 5.4260 (0.9); 5.4059 (0.9); 5.3951 (0.5); 2.9569 (3.7); 2.8816 (3.5); 2.6060 (0.4); 2.5936
(0.7); 2.5788 (1.8); 2.5615 (1.6); 2.5445 (0.9); 2.5118 (16.0); 2.4611 (0.3); 2.4465 (0.8); 2.4350 (0.4);
2.4248 (0.4); 2.3949 (11.5); 2.3119 (0.7); 2.2632 (0.4); 2.2197 (1.4); 2.1960 (0.7); 2.1742 (0.7);
1.9898 (0.4); 1.9648 (0.7); 1.9559 (0.8); 1.9387 (0.6); 1.9251 (0.7); 1.9029 (0.5); 1.8904 (0.6); 1.8574
(1.1); 1.8438 (1.1); 1.8341 (0.9); 1.8043 (0.5); 1.5776 (15.0); 1.4424 (0.6); 1.4272 (0.6); 1.3946 (0.4);
1.3661 (0.4); 1.3530 (0.4); 1.3258 (0.4); 1.2552 (1.1); 1.2069 (0.4); 1.1860 (0.4); 0.8554
(0.5); −0.0002 (5.0)
I-779: ¹H-NMR(400.1 MHz, CDCl3):
δ = 8.0107 (1.3); 7.3695 (1.6); 7.3495 (1.8); 7.2629 (11.7); 7.0596 (0.4); 7.0355 (4.5); 7.0218 (2.5);
7.0009 (0.5); 6.9705 (1.2); 6.9504 (1.0); 6.7601 (0.6); 6.7549 (0.7); 6.7433 (1.0); 6.7321 (0.9); 6.7203
(0.5); 6.5594 (0.5); 6.5445 (0.9); 6.5292 (0.5); 4.2517 (0.7); 4.2359 (0.8); 4.2147 (1.6); 4.1989 (1.6);
4.1776 (0.9); 4.1618 (0.8); 3.9620 (13.0); 2.9563 (8.2); 2.8818 (7.8); 2.4837 (16.0); 2.2972 (7.8);
2.0776 (0.5); 2.0691 (0.5); 2.0565 (1.0); 2.0438 (0.6); 2.0354 (0.6); 1.5979 (1.6); 1.0045 (0.5); 0.9926
(1.6); 0.9880 (1.8); 0.9767 (1.1); 0.9715 (1.8); 0.9669 (1.8); 0.9559 (0.8); 0.7536 (0.7); 0.7417 (2.1);
0.7384 (2.1); 0.7293 (2.0); 0.7254 (2.3); 0.7133 (0.8); −0.0002 (1.1)
I-780: ¹H-NMR(300.2 MHz, CDCl3):
δ = 8.2823 (11.9); 7.9799 (0.8); 7.9613 (1.3); 7.9441 (0.8); 7.5394 (1.0); 7.5299 (1.1); 7.5176 (2.2);
7.5062 (2.0); 7.4991 (1.1); 7.4856 (1.3); 7.3800 (3.5); 7.3534 (4.0); 7.2989 (14.1); 7.2811 (0.7);
7.2627 (4.7); 7.2562 (3.8); 7.2504 (3.4); 7.2377 (6.1); 7.2231 (0.4); 7.2129 (0.4); 7.0600 (3.8); 6.9707
(2.1); 6.9426 (3.7); 6.9051 (2.2); 6.8834 (2.2); 6.8460 (2.3); 5.9512 (3.7); 5.9490 (3.8); 5.8922 (3.4);
5.8899 (3.4); 5.5278 (3.8); 5.5257 (3.7); 5.4904 (3.5); 5.4883 (3.6); 5.3376 (5.5); 4.3051 (2.0); 4.2851
(2.0); 4.2576 (4.3); 4.2377 (4.1); 4.2101 (2.1); 4.1902 (2.1); 2.5170 (6.2); 2.5100 (11.7); 2.5026 (6.5);
2.3270 (0.3); 2.3008 (16.0); 1.5938 (8.4); 1.2946 (1.1); 0.0497 (0.6); 0.0388 (17.3); 0.0279 (0.6)
I-781: ¹H-NMR(300.2 MHz, CDCl3):
δ = 8.9200 (5.7); 7.8814 (0.4); 7.8632 (0.7); 7.8449 (0.4); 7.7006 (1.9); 7.6954 (1.4); 7.6833 (3.6);
7.5528 (1.6); 7.5127 (0.7); 7.5042 (0.6); 7.4988 (1.0); 7.4926 (0.9); 7.4826 (0.6); 7.4742 (0.4); 7.3813
(1.7); 7.3547 (1.9); 7.2987 (10.3); 7.0813 (1.9); 6.9924 (1.0); 6.9663 (0.9); 4.3465 (0.6); 4.3265 (0.9);
4.3067 (0.5); 4.2982 (1.0); 4.2781 (1.8); 4.2583 (0.9); 4.2498 (0.5); 4.2296 (1.0); 4.2100 (0.6); 3.0111
(16.0); 2.5168 (5.6); 2.5096 (3.1); 2.3229 (7.7); 2.0447 (1.5); 1.6133 (11.2); 1.2905 (0.6); 0.1068
(0.6); 0.0475 (0.4); 0.0366 (10.3); 0.0256 (0.3)
I-782: ¹H-NMR(499.9 MHz, d₆-DMSO):
δ = 9.3240 (0.3); 9.2647 (5.0); 8.0375 (0.3); 7.5370 (14.7); 7.4703 (0.7); 7.4340 (10.8); 7.4172 (13.7);
7.3196 (9.4); 7.3166 (8.8); 7.3028 (7.1); 7.2998 (6.5); 7.0686 (0.4); 7.0510 (0.4); 7.0342 (0.4); 6.9628
(4.0); 6.9469 (9.0); 6.9310 (6.7); 6.9008 (5.8); 6.8865 (7.8); 6.8713 (3.5); 6.7276 (4.8); 6.7144 (7.7);
6.7006 (4.1); 5.7828 (3.1); 5.6890 (3.1); 5.6570 (0.4); 4.2011 (0.4); 3.9929 (0.3); 3.9603 (0.3); 3.9395
(0.4); 3.9304 (0.4); 3.9260 (0.4); 3.9127 (0.4); 3.9062 (0.4); 3.8959 (0.3); 3.8738 (0.3); 3.8021 (0.4);
3.7884 (0.5); 3.7560 (0.5); 3.7429 (0.5); 3.6915 (1.8); 3.6821 (1.7); 3.6633 (3.0); 3.6539 (2.6); 3.6398
(2.0); 3.6119 (4.2); 3.6024 (4.5); 3.5890 (2.7); 3.5725 (3.2); 3.5602 (3.6); 3.5468 (2.4); 3.5311 (1.7);
3.5190 (1.1); 3.4776 (0.4); 2.4048 (24.4); 2.0027 (1.6); 1.9922 (3.5); 1.9856 (4.3); 1.9759 (6.5);
1.9659 (4.6); 1.9594 (3.9); 1.9490 (2.1); 1.8916 (0.4); 1.2596 (0.8); 1.2491 (0.6); 1.2351 (0.4); 1.1371
(1.2); 1.0852 (0.4); 1.0778 (0.4); 0.9353 (4.6); 0.9264 (12.6); 0.9227 (13.5); 0.9099 (13.3); 0.9061
(13.0); 0.8980 (5.6); 0.8682 (0.7); 0.7559 (0.4); 0.7407 (0.4); 0.7019 (0.6); 0.6716 (5.7); 0.6603
(16.0); 0.6531 (15.6); 0.6504 (15.3); 0.6411 (5.3); −0.0002 (0.9); −0.0339 (0.4); −0.0836 (0.4)
I-783: ¹H-NMR(300.2 MHz, CDCl3):
δ = 7.4531 (2.0); 7.4251 (2.6); 7.4093 (2.5); 7.2986 (2.5); 7.2307 (1.6); 7.2242 (1.5); 7.2029 (1.3);
7.1963 (1.2); 7.0901 (3.0); 7.0742 (2.2); 7.0708 (2.2); 7.0655 (2.8); 7.0475 (0.4); 6.9136 (0.8); 6.8305
(0.7); 6.8182 (0.7); 6.8095 (1.1); 6.7986 (1.1); 6.7868 (0.7); 6.7768 (0.6); 6.0668 (0.5); 6.0569 (0.5);
6.0437 (0.6); 6.0338 (0.5); 5.9118 (0.5); 5.9018 (0.5); 5.8887 (0.6); 5.8786 (0.5); 4.1695 (0.3); 4.1593
(0.4); 4.1483 (0.4); 4.1231 (16.0); 4.0802 (0.4); 4.0701 (0.4); 4.0590 (0.4); 4.0490 (0.3); 3.9182 (0.5);
3.8959 (0.4); 3.8666 (0.6); 3.8461 (0.6); 3.8227 (0.4); 3.8176 (0.3); 3.7938 (0.4); 2.1184 (0.5); 2.1074
(0.6); 2.0903 (1.1); 2.0731 (0.7); 2.0621 (0.6); 2.0447 (0.3); 1.2912 (0.4); 1.0589 (0.7); 1.0433 (2.0);
1.0367 (2.2); 1.0219 (1.3); 1.0149 (2.1); 1.0086 (2.0); 0.9939 (0.9); 0.8990 (0.3); 0.8779 (0.4); 0.7973
(0.9); 0.7820 (2.4); 0.7770 (2.3); 0.7654 (2.2); 0.7599 (2.5); 0.7435 (0.7); 0.0358 (1.7)
I-784: ¹H-NMR(300.2 MHz, CDCl3):
δ = 7.3722 (0.8); 7.3651 (1.1); 7.3601 (1.9); 7.3507 (0.9); 7.3462 (1.1); 7.3401 (1.5); 7.3334 (2.2);
7.3278 (1.1); 7.3180 (0.9); 7.2989 (1.2); 7.2187 (0.4); 7.2121 (0.5); 7.1912 (1.6); 7.1846 (1.1); 7.1727
(1.9); 7.1685 (2.8); 7.1638 (1.4); 7.1455 (1.3); 7.1414 (1.4); 7.1179 (0.4); 7.1141 (0.5); 7.0708 (1.9);
6.9777 (1.0); 6.9512 (0.9); 6.8647 (0.5); 6.8439 (1.0); 6.8233 (0.5); 5.3307 (0.4); 4.2481 (0.8); 4.2270
(0.8); 4.1999 (1.7); 4.1788 (1.6); 4.1516 (0.9); 4.1306 (0.8); 3.1936 (0.6); 2.5119 (5.6); 2.3565 (0.5);
2.3323 (16.0); 2.3206 (8.1); 1.7043 (1.2); 1.3062 (0.3); 0.9208 (0.4); 0.0397 (1.2)
I-785: ¹H-NMR(499.9 MHz, CDCl3):
δ = 7.5516 (0.6); 7.5360 (2.3); 7.5217 (6.8); 7.5190 (3.6); 7.5101 (0.6); 7.5076 (0.7); 7.5030 (0.4);
7.4542 (0.4); 7.4469 (13.1); 7.4428 (3.7); 7.4246 (1.4); 7.4199 (2.3); 7.4156 (1.2); 7.4117 (0.9);
7.4100 (0.9); 7.4063 (1.5); 7.4018 (0.9); 7.3703 (3.4); 7.3544 (3.7); 7.2589 (18.4); 7.0649 (3.4);
6.9872 (1.6); 6.9713 (1.4); 4.7408 (2.8); 4.7385 (3.6); 4.7366 (3.6); 4.7344 (3.0); 4.6531 (0.9); 4.6254
(1.7); 4.5927 (4.6); 4.5885 (4.3); 2.5176 (0.4); 2.4899 (9.5); 2.4487 (0.4); 2.3274 (14.5); 2.3101 (0.6);
1.9308 (0.8); 1.9138 (0.6); 1.9127 (0.6); 1.8575 (16.0); 1.5410 (16.7); 1.2549 (0.4); 0.0700 (2.3);
0.0063 (0.7); −0.0002 (21.5); −0.0068 (0.9)
I-786: ¹H-NMR(300.2 MHz, CDCl3):
δ = 7.3819 (0.8); 7.3750 (1.2); 7.3698 (2.0); 7.3603 (1.0); 7.3558 (1.2); 7.3508 (1.4); 7.3494 (1.4);
7.3426 (2.2); 7.3369 (1.1); 7.3277 (1.0); 7.2987 (2.8); 7.2335 (0.4); 7.2269 (0.6); 7.2059 (1.6); 7.1994
(1.1); 7.1872 (1.8); 7.1817 (2.6); 7.1584 (1.3); 7.1542 (1.4); 7.1308 (0.4); 7.1267 (0.5); 6.9527 (2.0);
6.8656 (1.1); 6.8385 (1.0); 6.5955 (0.5); 6.5751 (0.9); 6.5545 (0.5); 5.3349 (0.6); 4.2666 (0.8); 4.2456
(0.8); 4.2185 (1.8); 4.1975 (1.7); 4.1703 (0.9); 4.1493 (0.8); 3.2140 (0.9); 2.5211 (5.8); 2.5146 (3.4);
2.4170 (0.4); 2.3614 (16.0); 2.0739 (0.3); 1.8925 (0.5); 1.8812 (0.6); 1.8647 (1.0); 1.8480 (0.6);
1.8368 (0.6); 1.6368 (1.9); 1.3035 (0.4); 1.2923 (0.4); 1.0492 (0.8); 1.0340 (1.9); 1.0271 (2.1); 1.0215
(1.1); 1.0122 (1.2); 1.0056 (2.0); 0.9991 (1.8); 0.9844 (0.9); 0.7344 (1.0); 0.7192 (2.3); 0.7132 (2.1);
0.7027 (1.9); 0.6969 (2.4); 0.6807 (0.7); 0.0383 (3.5)
I-787: ¹H-NMR(300.2 MHz, CDCl3):
δ = 7.2989 (1.0); 7.1167 (0.4); 7.0891 (1.8); 7.0807 (1.3); 7.0684 (3.5); 7.0598 (2.7); 7.0524 (1.5);
7.0341 (2.2); 7.0255 (0.4); 6.9805 (0.3); 6.9662 (1.8); 6.8670 (1.1); 6.8400 (1.4); 6.8277 (0.7); 6.8187
(1.0); 6.8096 (0.9); 6.7930 (0.6); 6.7860 (0.5); 6.5084 (0.4); 6.4891 (0.8); 6.4697 (0.4); 3.7706 (0.8);
3.7475 (2.2); 3.7271 (2.2); 3.7043 (0.9); 2.9552 (1.5); 2.9321 (2.9); 2.9089 (1.3); 2.4054 (16.0);
2.3229 (10.7); 2.2715 (9.7); 2.2374 (0.5); 2.1851 (0.4); 2.1100 (0.5); 2.0989 (0.5); 2.0816 (0.9);
2.0704 (0.3); 2.0643 (0.5); 2.0535 (0.5); 1.7234 (0.8); 1.0634 (0.7); 1.0481 (1.7); 1.0413 (1.8); 1.0353
(1.0); 1.0266 (1.0); 1.0195 (1.8); 1.0129 (1.6); 0.9984 (0.8); 0.8060 (0.9); 0.7911 (2.0); 0.7849 (2.0);
0.7740 (1.8); 0.7684 (2.1); 0.7520 (0.6); 0.0454 (1.1)
I-788: ¹H-NMR(300.2 MHz, CDCl3):
δ = 7.5123 (1.0); 7.4832 (2.6); 7.4555 (2.3); 7.3851 (0.6); 7.3775 (0.8); 7.3631 (0.9); 7.3602 (1.0);
7.3521 (1.2); 7.3443 (0.7); 7.3308 (0.9); 7.2986 (4.3); 7.2119 (0.5); 7.1921 (1.6); 7.1783 (4.2); 7.1649
(1.4); 7.1580 (1.9); 7.1284 (0.4); 7.0142 (1.2); 6.9874 (1.1); 6.8087 (0.5); 6.7878 (1.0); 6.7668 (0.5);
5.3307 (2.0); 4.4551 (0.9); 4.4338 (0.8); 4.4076 (1.9); 4.3863 (1.8); 4.3602 (1.0); 4.3388 (0.9); 3.4191
(1.3); 3.3692 (2.6); 3.3192 (1.3); 2.3894 (4.8); 2.3647 (16.0); 2.3339 (8.7); 0.0349 (1.9)
I-789: ¹H-NMR(300.2 MHz, CDCl3):
δ = 7.4246 (1.8); 7.3965 (2.3); 7.3904 (0.9); 7.3817 (0.8); 7.3682 (1.0); 7.3661 (1.0); 7.3573 (1.0);
7.3523 (1.2); 7.3357 (0.9); 7.3004 (1.2); 7.2986 (2.2); 7.2640 (1.9); 7.2119 (0.4); 7.1929 (1.7); 7.1843
(3.0); 7.1822 (3.1); 7.1656 (2.2); 7.1633 (2.3); 7.1455 (1.2); 7.1176 (0.9); 6.7570 (0.5); 6.7361 (1.0);
6.7155 (0.5); 5.3340 (0.6); 4.2637 (0.9); 4.2425 (0.8); 4.2157 (1.8); 4.1944 (1.8); 4.1676 (0.9); 4.1464
(0.9); 3.2087 (0.4); 2.5513 (6.1); 2.3529 (16.0); 1.6470 (1.2); 1.3029 (0.9); 1.2946 (0.9); 0.9180 (1.0);
0.8949 (0.4); 0.0382 (1.3); 0.0364 (2.7)
I-790: ¹H-NMR(300.2 MHz, CDCl3):
δ = 7.3972 (1.1); 7.3884 (2.0); 7.3704 (2.8); 7.3619 (2.3); 7.3436 (2.0); 7.2992 (8.6); 7.2916 (1.5);
7.2877 (1.6); 7.2852 (1.7); 7.2817 (1.6); 7.2584 (1.0); 7.2550 (0.9); 7.2235 (1.5); 7.2165 (2.5); 7.2099
(1.4); 7.1314 (1.2); 7.1282 (1.4); 7.1241 (1.3); 7.1209 (1.2); 7.0970 (3.2); 7.0172 (1.2); 6.9914 (1.0);
6.4983 (0.5); 6.4776 (0.9); 6.4584 (0.5); 4.2780 (1.0); 4.2570 (0.9); 4.2294 (2.0); 4.2085 (2.0); 4.1809
(1.0); 4.1598 (1.0); 2.5290 (6.4); 2.3727 (16.0); 2.3468 (8.8); 2.3211 (0.5); 1.5923 (5.2); 1.3029 (0.7);
0.9205 (0.6); 0.1085 (0.3); 0.0494 (0.4); 0.0386 (10.9)
I-791: ¹H-NMR(300.2 MHz, CDCl3):
δ = 8.2936 (9.3); 7.9845 (1.2); 7.5459 (1.0); 7.5372 (1.2); 7.5232 (1.9); 7.5139 (1.5); 7.5089 (1.8);
7.4919 (1.2); 7.4689 (3.3); 7.4402 (4.8); 7.4316 (4.0); 7.4275 (3.1); 7.2995 (10.9); 7.2821 (2.5);
7.2718 (4.6); 7.2540 (7.0); 7.2288 (2.2); 7.2228 (2.1); 6.9442 (1.7); 6.9068 (1.8); 6.8851 (1.9); 6.8477
(2.0); 6.1449 (0.8); 6.1341 (0.9); 6.1227 (0.9); 6.1120 (0.9); 5.9902 (0.8); 5.9798 (0.9); 5.9682 (1.0);
5.9512 (3.9); 5.8921 (3.3); 5.5295 (3.6); 5.4921 (3.4); 5.3383 (16.0); 4.3361 (0.4); 4.3254 (0.5);
4.3145 (0.5); 4.3036 (0.5); 4.2873 (0.6); 4.2765 (0.6); 4.2656 (0.6); 4.2519 (0.7); 4.2400 (0.5); 4.2290
(0.5); 4.2180 (0.5); 4.2020 (0.6); 4.1913 (0.6); 4.1801 (0.6); 4.1694 (0.6); 3.9620 (0.6); 3.9402 (0.7);
3.9218 (0.6); 3.9132 (0.5); 3.8873 (0.8); 3.8689 (0.8); 3.8466 (0.6); 3.8381 (0.5); 3.8161 (0.6); 3.7976
(0.4); 1.5932 (6.1); 1.2929 (0.4); 0.1086 (0.5); 0.0490 (0.5); 0.0383 (13.2); 0.0276 (0.6)
I-792: ¹H-NMR(300.2 MHz, d₆-DMSO):
δ = 9.1395 (0.6); 9.1197 (1.4); 9.1003 (0.6); 8.0795 (6.6); 7.9586 (1.4); 7.9328 (1.7); 7.8139 (1.7);
7.8073 (2.4); 7.8014 (1.7); 7.7579 (2.7); 7.7006 (1.3); 7.6740 (2.6); 7.6480 (1.6); 7.5650 (1.4); 7.5599
(1.3); 7.5575 (1.3); 7.5382 (0.9); 7.5330 (1.0); 7.5197 (0.4); 7.4912 (6.4); 6.0885 (0.4); 6.0710 (0.9);
6.0549 (0.5); 5.9345 (0.4); 5.9175 (1.0); 5.9013 (0.5); 5.7776 (1.7); 3.9326 (0.8); 3.9141 (1.2); 3.8957
(0.7); 3.8553 (0.8); 3.8370 (1.3); 3.8191 (0.7); 3.3423 (16.0); 2.6313 (15.8); 2.5340 (1.8); 2.5283
(3.9); 2.5224 (5.4); 2.5165 (4.0); 0.0200 (3.3)
I-793: ¹H-NMR(400.2 MHz, d₆-DMSO):
δ = 9.0907 (0.5); 8.3097 (0.4); 7.7748 (2.3); 7.7262 (0.6); 7.7066 (0.5); 7.6815 (0.6); 7.6195 (0.8);
7.5626 (0.4); 7.3180 (0.7); 7.2980 (0.8); 7.0696 (0.7); 6.9361 (0.4); 6.9151 (0.4); 4.2476 (0.4); 4.1239
(0.4); 4.1133 (0.3); 4.1102 (0.4); 4.1031 (0.4); 4.0923 (0.6); 4.0771 (0.6); 4.0554 (0.4); 4.0401 (0.4);
3.3282 (88.3); 3.2411 (0.4); 2.6719 (0.4); 2.5423 (4.5); 2.5254 (1.0); 2.5207 (1.6); 2.5121 (22.8);
2.5076 (46.7); 2.5030 (61.5); 2.4984 (44.6); 2.4938 (21.7); 2.4197 (2.1); 2.3298 (0.4); 2.2199 (2.9);
2.0723 (1.4); 1.3907 (16.0); 1.3729 (1.0); −0.0002 (2.9)
I-794: ¹H-NMR(400.2 MHz, d₆-DMSO):
δ = 10.8023 (0.3); 9.3200 (1.2); 9.3041 (2.2); 9.2891 (1.1); 9.0821 (9.2); 8.9856 (0.5); 8.3101 (10.8);
7.7368 (1.1); 7.7175 (2.9); 7.6976 (2.5); 7.6694 (3.1); 7.6486 (1.7); 7.6115 (0.6); 7.5719 (3.8); 7.5453
(2.3); 7.5263 (1.9); 7.3291 (3.6); 7.3089 (4.1); 7.2811 (0.5); 7.2742 (0.5); 7.2603 (0.5); 7.2518 (0.4);
7.1391 (0.5); 7.0996 (4.4); 6.9733 (2.1); 6.9527 (2.0); 5.8056 (0.5); 5.7869 (1.0); 5.7673 (0.5); 4.6146
(1.0); 4.5961 (1.6); 4.5773 (0.9); 4.4239 (0.4); 4.4150 (0.4); 4.2064 (0.4); 4.1799 (1.1); 4.1642 (1.3);
4.1420 (2.4); 4.1271 (2.5); 4.1064 (1.6); 4.0897 (1.5); 4.0572 (0.5); 4.0398 (1.2); 4.0272 (1.2); 4.0192
(2.1); 4.0064 (2.1); 3.9982 (1.4); 3.9861 (1.3); 3.8817 (0.8); 3.8551 (2.2); 3.8336 (3.3); 3.8151 (2.8);
3.7954 (0.9); 3.7813 (1.8); 3.7624 (3.4); 3.7416 (3.2); 3.7224 (1.8); 3.6998 (3.2); 3.6848 (3.2); 3.6785
(2.8); 3.6630 (2.7); 3.6465 (1.2); 3.6301 (1.1); 3.4562 (1.7); 3.3298 (3319.8); 3.2420 (0.6); 3.1478
(0.5); 3.1306 (1.1); 3.1093 (1.3); 3.0915 (1.0); 3.0750 (0.4); 2.7123 (0.7); 2.6808 (4.0); 2.6762 (8.4);
2.6717 (11.9); 2.6672 (8.8); 2.6628 (4.4); 2.6514 (0.6); 2.5420 (117.9); 2.5252 (36.7); 2.5205 (54.3);
2.5117 (693.4); 2.5073 (1414.5); 2.5028 (1866.6); 2.4982 (1375.8); 2.4938 (692.3); 2.4395 (11.8);
2.3674 (2.0); 2.3341 (8.2); 2.3296 (11.6); 2.3251 (8.8); 2.2890 (3.2); 2.2484 (16.0); 2.2204 (1.9);
2.2092 (1.6); 2.1994 (1.8); 2.1883 (1.1); 2.1795 (0.8); 2.1721 (1.9); 2.0724 (2.5); 2.0489 (0.6); 2.0313
(1.2); 2.0116 (1.3); 2.0001 (1.2); 1.9826 (1.0); 1.9626 (0.6); 1.9141 (0.4); 1.9019 (0.4); 1.5812 (0.4);
1.4675 (0.5); 1.4513 (0.5); 1.4421 (0.5); 1.4331 (0.4); 1.4199 (0.5); 1.4040 (0.5); 1.3821 (0.8); 1.3679
(0.6); 1.3425 (1.1); 1.2355 (0.7); 1.2008 (0.4); 1.1812 (0.6); 1.0572 (0.4); 0.0079 (1.4); −0.0002
(54.2); −0.0084 (2.1)
I-795: ¹H-NMR(400.2 MHz, d₆-DMSO):
δ = 9.3286 (0.3); 9.1070 (1.2); 9.0915 (2.5); 9.0755 (1.2); 8.3106 (1.2); 7.8534 (12.3); 7.7438 (1.1);
7.7242 (3.3); 7.7045 (2.9); 7.6787 (3.3); 7.6584 (1.7); 7.6232 (4.0); 7.5911 (0.6); 7.5608 (2.3); 7.5421
(1.8); 7.3302 (0.6); 7.3151 (3.9); 7.2952 (4.2); 7.0977 (0.6); 7.0701 (4.1); 6.9187 (2.2); 6.8987 (2.0);
4.4380 (1.3); 4.1283 (1.3); 4.1124 (1.3); 4.0911 (2.8); 4.0752 (2.7); 4.0537 (1.4); 4.0379 (1.3); 3.5104
(0.4); 3.5017 (0.6); 3.4941 (0.6); 3.4887 (0.7); 3.4833 (0.4); 3.4472 (0.4); 3.4410 (0.7); 3.4360 (0.6);
3.4281 (0.7); 3.4197 (0.5); 3.3984 (0.4); 3.3895 (0.4); 3.3324 (402.1); 3.2823 (0.4); 3.2558 (1.8);
3.2513 (0.8); 3.2409 (0.8); 3.2371 (0.6); 3.2286 (0.7); 3.2186 (5.4); 3.2115 (0.8); 3.2025 (0.5); 3.1916
(3.2); 3.1726 (4.2); 3.1671 (2.8); 3.1523 (3.8); 2.8386 (0.6); 2.8240 (0.4); 2.8106 (2.0); 2.7960 (1.4);
2.7901 (2.0); 2.7867 (1.8); 2.7825 (2.2); 2.7710 (1.8); 2.7679 (1.8); 2.7620 (2.0); 2.7585 (1.6); 2.7547
(1.0); 2.7428 (1.7); 2.7337 (0.7); 2.7143 (0.6); 2.6808 (0.4); 2.6766 (0.9); 2.6720 (1.3); 2.6675 (1.0);
2.6630 (0.5); 2.5423 (8.9); 2.5255 (4.1); 2.5208 (6.1); 2.5121 (73.4); 2.5077 (149.9); 2.5031 (198.0);
2.4985 (144.0); 2.4939 (70.5); 2.4183 (11.6); 2.3391 (0.4); 2.3345 (0.9); 2.3299 (1.2); 2.3253 (0.9);
2.3208 (0.4); 2.2466 (2.2); 2.2195 (16.0); 2.0726 (1.2); −0.0002 (7.8)
I-796: ¹H-NMR(400.2 MHz, d₆-DMSO):
δ = 9.0927 (0.5); 9.0771 (0.9); 9.0615 (0.4); 8.3098 (0.4); 7.7392 (0.5); 7.7196 (1.2); 7.6995 (1.2);
7.6940 (4.8); 7.6724 (1.2); 7.6532 (0.7); 7.6290 (1.5); 7.5626 (0.9); 7.5424 (0.7); 7.3104 (1.5); 7.2904
(1.7); 7.0687 (1.6); 6.9202 (0.8); 6.9008 (0.8); 4.1252 (0.5); 4.1091 (0.5); 4.0879 (1.1); 4.0722 (1.0);
4.0507 (0.5); 4.0353 (0.5); 3.7168 (1.6); 3.7009 (3.4); 3.6852 (1.6); 3.3315 (81.4); 3.2673 (0.7);
3.2637 (0.8); 3.2509 (0.6); 3.2426 (1.3); 3.2370 (16.0); 3.2106 (0.5); 3.1425 (1.4); 3.1268 (2.9);
3.1109 (1.3); 2.6722 (0.4); 2.5425 (12.1); 2.5256 (1.1); 2.5208 (1.6); 2.5121 (21.2); 2.5077 (42.8);
2.5032 (56.2); 2.4986 (41.2); 2.4941 (20.4); 2.4181 (4.5); 2.3298 (0.4); 2.2461 (0.5); 2.2221
(6.3); −0.0002 (2.7)
I-797: ¹H-NMR(400.2 MHz, d₆-DMSO):
δ = 20.0078 (1.5); 9.0381 (2.2); 8.3104 (13.2); 7.7133 (2.7); 7.6941 (2.8); 7.6715 (3.1); 7.6338 (11.5);
7.6244 (4.0); 7.5575 (2.2); 7.5379 (1.8); 7.3466 (1.1); 7.3277 (4.9); 7.3114 (16.0); 7.2665 (4.6);
7.2463 (5.6); 7.0427 (4.0); 6.8704 (2.2); 6.8507 (2.0); 5.7858 (1.0); 4.5958 (1.7); 4.2538 (11.6);
4.0551 (2.7); 4.0400 (2.7); 3.3280 (3955.0); 3.2555 (3.8); 2.6761 (11.4); 2.6715 (15.6); 2.6670 (11.6);
2.5419 (48.2); 2.5250 (48.3); 2.5202 (72.0); 2.5116 (896.2); 2.5071 (1806.4); 2.5026 (2365.1);
2.4980 (1722.7); 2.4935 (848.8); 2.3883 (10.7); 2.3339 (10.6); 2.3294 (14.6); 2.3248 (10.9); 2.2868
(1.5); 2.2096 (14.8); 2.1642 (1.5); 2.0725 (2.6); 1.3424 (1.9); 1.2348 (2.5); 0.1392 (3.0); 0.0080
(4.1); −0.0002 (107.1); −0.0085 (3.1); −0.0242 (1.0)
I-798: ¹H-NMR(400.2 MHz, d₆-DMSO):
δ = 9.0736 (1.1); 9.0580 (2.3); 9.0424 (1.1); 8.3108 (1.4); 7.7336 (1.0); 7.7140 (3.0); 7.6943 (2.6);
7.6667 (4.8); 7.6483 (1.6); 7.6101 (3.9); 7.5941 (10.3); 7.5501 (2.2); 7.5304 (1.7); 7.3083 (3.4);
7.2884 (3.7); 7.0685 (4.1); 6.9200 (2.2); 6.9002 (2.0); 5.7876 (0.5); 5.0531 (0.4); 5.0103 (0.4); 5.0030
(0.4); 4.9774 (0.3); 4.6152 (0.3); 4.5965 (0.6); 4.1203 (1.1); 4.1048 (1.2); 4.0834 (2.6); 4.0676 (2.5);
4.0463 (1.3); 4.0307 (1.2); 3.3304 (409.6); 3.2690 (0.4); 3.2128 (0.6); 3.2087 (0.3); 2.9930 (5.6);
2.9740 (6.3); 2.9120 (0.5); 2.8928 (0.7); 2.8737 (0.5); 2.7052 (0.6); 2.6857 (1.5); 2.6763 (1.3); 2.6717
(1.9); 2.6669 (3.1); 2.6472 (1.5); 2.6277 (0.6); 2.5421 (3.5); 2.5253 (4.6); 2.5205 (6.9); 2.5118 (94.2);
2.5074 (193.2); 2.5029 (256.5); 2.4983 (188.9); 2.4938 (94.8); 2.4153 (11.2); 2.3388 (0.6); 2.3342
(1.2); 2.3296 (1.7); 2.3252 (1.2); 2.3210 (0.6); 2.2477 (0.5); 2.2204 (16.0); 2.0831 (0.5); 2.0725 (0.5);
2.0650 (0.6); 2.0252 (0.6); 2.0070 (1.3); 1.9982 (1.4); 1.9912 (1.9); 1.9864 (1.8); 1.9786 (1.4); 1.9713
(1.7); 1.9560 (0.7); 1.9509 (0.7); 1.8721 (0.6); 1.8674 (0.5); 1.8475 (1.7); 1.8340 (2.6); 1.8272 (2.0);
1.8135 (2.3); 1.7985 (1.4); 1.7880 (0.6); 1.7696 (1.4); 1.7507 (1.9); 1.7465 (2.0); 1.7219 (2.2); 1.7017
(1.5); 0.0080 (0.4); −0.0002 (12.3); −0.0084 (0.5)
I-799: ¹H-NMR(300.2 MHz, CDCl3):
δ = 7.8991 (1.3); 7.8895 (1.3); 7.6259 (0.4); 7.5999 (1.8); 7.5804 (4.5); 7.5778 (4.7); 7.4799 (2.4);
7.4578 (0.4); 7.4408 (1.0); 7.4312 (1.5); 7.4240 (1.2); 7.4081 (2.9); 7.3811 (2.4); 7.2996 (6.6); 7.0921
(2.6); 7.0128 (1.4); 6.9864 (1.3); 6.5109 (0.6); 6.4898 (1.3); 6.4698 (0.7); 4.3155 (1.0); 4.2946 (1.0);
4.2670 (2.1); 4.2462 (2.1); 4.2186 (1.1); 4.1977 (1.1); 2.9496 (0.5); 2.9371 (0.8); 2.9256 (1.2); 2.9131
(1.2); 2.9012 (0.8); 2.8892 (0.6); 2.6912 (16.0); 2.6624 (0.4); 2.5379 (7.5); 2.3590 (0.5); 2.3225 (9.9);
2.2380 (0.4); 1.6269 (5.2); 1.2918 (3.2); 0.9169 (1.1); 0.8934 (3.2); 0.8747 (2.9); 0.8702 (2.7); 0.8516
(1.1); 0.6436 (0.9); 0.6266 (2.4); 0.6199 (2.5); 0.6139 (2.4); 0.6098 (2.3); 0.5902 (0.7); 0.1079 (5.5);
0.0371 (7.0)
I-800: ¹H-NMR(300.2 MHz, CDCl3):
δ = 9.2572 (1.0); 7.7910 (0.6); 7.7636 (0.8); 7.7475 (0.6); 7.7194 (0.7); 7.5093 (11.1); 7.4942 (8.8);
7.4570 (7.6); 7.4467 (8.3); 7.4104 (3.3); 7.2992 (18.0); 7.2760 (3.7); 7.2701 (3.4); 7.2214 (0.7);
7.2026 (0.7); 7.1508 (0.4); 6.8284 (0.5); 6.8180 (0.5); 6.7987 (0.5); 6.2333 (1.3); 6.2146 (1.3); 6.0757
(1.3); 6.0576 (1.4); 4.6385 (0.6); 4.6253 (0.7); 4.5883 (0.8); 4.5782 (0.8); 4.5370 (0.7); 4.5250 (0.7);
4.4883 (0.8); 4.4776 (0.8); 4.1507 (0.8); 4.1285 (1.0); 4.1105 (1.2); 4.0969 (1.2); 4.0678 (1.0); 4.0402
(0.7); 4.0224 (0.5); 3.9117 (0.4); 3.8980 (0.4); 3.8541 (3.9); 2.7236 (0.4); 2.7155 (0.4); 2.6539 (1.4);
2.6287 (1.1); 2.5313 (13.0); 2.4708 (1.3); 2.4313 (1.4); 2.3998 (1.0); 2.3885 (1.2); 2.3543 (1.2);
2.3127 (0.7); 2.2875 (0.7); 2.2782 (0.7); 2.1860 (16.0); 1.9718 (0.3); 1.9167 (0.4); 1.8941 (0.3);
1.4604 (0.5); 1.4034 (1.0); 1.3735 (1.0); 1.2919 (11.9); 1.1952 (0.8); 1.1724 (0.8); 1.1482 (0.7);
1.0577 (0.3); 0.9176 (1.2); 0.8923 (1.2); 0.8670 (1.1); 0.1079 (12.6); 0.0374 (14.6)
I-801: ¹H-NMR(300.2 MHz, CDCl3):
δ = 7.8534 (0.4); 7.6108 (0.7); 7.5899 (2.0); 7.4909 (1.0); 7.4542 (0.4); 7.4457 (0.7); 7.4386 (0.4);
7.4233 (0.5); 7.4106 (1.0); 7.3838 (1.0); 7.2996 (7.8); 7.0935 (1.1); 7.0159 (0.6); 6.9885 (0.5); 6.3494
(0.5); 4.3246 (0.4); 4.3035 (0.4); 4.2763 (0.9); 4.2554 (0.9); 4.2278 (0.5); 4.2071 (0.5); 3.4515 (0.6);
3.4286 (1.2); 3.4063 (1.2); 3.3846 (0.6); 2.6986 (7.3); 2.5411 (3.2); 2.3238 (4.2); 1.6777 (0.6); 1.6534
(1.2); 1.6295 (1.3); 1.6035 (16.0); 1.2921 (0.4); 1.0201 (1.9); 0.9956 (3.8); 0.9708 (1.7); 0.1075 (0.9);
0.0377 (8.2)
I-802: ¹H-NMR(600.1 MHz, CDCl3):
δ = 8.1678 (9.0); 7.9688 (0.8); 7.9597 (1.5); 7.9504 (0.8); 7.6407 (0.7); 7.6276 (2.6); 7.6158 (7.4);
7.6057 (0.6); 7.6042 (0.6); 7.4790 (3.6); 7.4453 (0.4); 7.4349 (1.3); 7.4312 (2.4); 7.4277 (1.4); 7.4243
(1.0); 7.4199 (1.8); 7.4163 (1.1); 7.3280 (3.5); 7.3147 (3.8); 7.2615 (13.8); 7.0328 (4.0); 6.9377 (2.1);
6.9244 (2.0); 4.4510 (0.8); 4.2461 (1.5); 4.2362 (1.5); 4.2221 (3.4); 4.2122 (3.3); 4.1980 (1.7); 4.1882
(1.6); 4.0989 (2.8); 3.4455 (1.6); 3.2241 (4.1); 3.2147 (6.9); 3.2053 (3.9); 3.1927 (0.3); 2.7323 (0.9);
2.5000 (0.9); 2.4746 (11.2); 2.3007 (1.0); 2.2938 (0.5); 2.2764 (16.0); 2.2652 (0.6); 1.6111 (2.0);
1.4271 (0.4); 1.3337 (1.3); 1.2847 (1.8); 1.2561 (1.8); 0.8813 (0.5); 0.8694 (0.3); −0.0001 (2.6)
I-803: ¹H-NMR(600.1 MHz, CDCl3):
δ = 8.1675 (9.3); 7.9564 (0.8); 7.9471 (1.5); 7.9377 (0.8); 7.6199 (0.6); 7.6068 (2.5); 7.5956 (7.0);
7.5861 (0.5); 7.5845 (0.6); 7.4671 (3.3); 7.4244 (1.2); 7.4204 (2.2); 7.4167 (1.4); 7.4143 (0.9); 7.4127
(0.9); 7.4094 (1.6); 7.4057 (0.9); 7.3269 (3.3); 7.3136 (3.5); 7.2615 (14.5); 7.0303 (3.7); 6.9339 (2.0);
6.9206 (1.8); 4.2430 (1.4); 4.2332 (1.3); 4.2190 (3.1); 4.2092 (3.0); 4.1950 (1.5); 4.1852 (1.4); 4.1328
(2.3); 4.1209 (7.0); 4.1090 (7.0); 4.0971 (2.3); 3.3003 (3.4); 3.2883 (7.6); 3.2763 (3.9); 2.9154 (4.0);
2.9034 (8.0); 2.8914 (3.6); 2.4737 (10.2); 2.2748 (14.9); 1.5808 (9.6); 1.3337 (1.2); 1.2849 (1.6);
1.2554 (2.1); 1.2395 (8.1); 1.2276 (16.0); 1.2157 (7.8); 0.8806 (0.5); 0.8688 (0.3); 0.8444 (0.4);
0.8408 (0.4); −0.0001 (2.8)
I-804: ¹H-NMR(400.2 MHz, d₆-DMSO):
δ = 9.3197 (0.5); 9.3045 (1.0); 9.2892 (0.5); 7.9531 (0.5); 7.6815 (0.6); 7.6621 (1.3); 7.6424 (1.0);
7.6108 (1.2); 7.5912 (0.6); 7.4651 (1.6); 7.4501 (1.0); 7.4304 (0.7); 7.2847 (1.4); 7.2780 (0.4); 7.2647
(1.6); 7.0583 (1.9); 6.8780 (0.9); 6.8566 (1.2); 6.8407 (1.1); 6.8254 (0.5); 4.1040 (0.4); 4.0888 (0.4);
4.0658 (0.9); 4.0504 (0.8); 4.0273 (0.5); 4.0115 (0.5); 3.4301 (0.6); 3.4141 (1.4); 3.3963 (1.4); 3.3802
(0.6); 3.3299 (34.9); 2.8905 (4.0); 2.7318 (3.3); 2.7312 (3.3); 2.7165 (1.4); 2.6985 (2.1); 2.6817 (1.2);
2.5627 (2.5); 2.5249 (0.5); 2.5201 (0.7); 2.5113 (10.1); 2.5069 (20.7); 2.5023 (27.3); 2.4978 (19.7);
2.4933 (9.6); 2.3918 (4.6); 2.2145 (6.2); 2.2039 (1.3); 2.0612 (16.0); 1.2392 (1.0); −0.0002 (2.6)
I-805: ¹H-NMR(400.2 MHz, d₆-DMSO):
δ = 9.3451 (0.5); 9.3292 (1.1); 9.3233 (1.2); 9.3076 (2.2); 9.2921 (1.0); 7.9530 (2.1); 7.6846 (1.2);
7.6648 (3.3); 7.6452 (2.7); 7.6137 (3.4); 7.5939 (1.7); 7.4785 (3.5); 7.4587 (2.4); 7.4390 (1.9); 7.2910
(3.1); 7.2710 (3.5); 7.0659 (4.4); 6.9066 (0.8); 6.8915 (2.0); 6.8729 (1.6); 6.7698 (0.4); 6.7555 (0.9);
6.7404 (0.4); 6.4927 (0.9); 6.4788 (2.0); 6.4646 (1.0); 5.0690 (0.4); 5.0570 (1.6); 5.0449 (1.6); 5.0330
(0.4); 4.9771 (0.9); 4.9652 (3.6); 4.9532 (3.6); 4.9412 (1.0); 4.4027 (0.4); 4.3920 (0.5); 4.3839 (0.5);
4.3734 (0.4); 4.3490 (0.4); 4.3370 (0.9); 4.3241 (1.2); 4.3205 (1.2); 4.3069 (1.1); 4.2954 (0.4); 4.1009
(0.9); 4.0853 (1.0); 4.0715 (1.5); 4.0625 (2.0); 4.0551 (2.0); 4.0501 (2.4); 4.0339 (1.3); 4.0242 (1.3);
4.0083 (1.0); 3.9879 (0.4); 3.8638 (1.5); 3.8460 (1.9); 3.8424 (2.7); 3.8248 (2.0); 3.7679 (2.1); 3.7568
(2.0); 3.7465 (1.5); 3.7354 (1.4); 3.4761 (0.8); 3.4607 (0.8); 3.4547 (0.8); 3.4392 (0.8); 3.4160 (0.6);
3.4008 (0.9); 3.3907 (0.6); 3.3812 (1.7); 3.3688 (2.0); 3.3553 (2.0); 3.3391 (3.4); 3.3295 (99.4);
3.3056 (1.2); 3.2910 (0.6); 2.8903 (16.0); 2.7319 (13.0); 2.7308 (13.6); 2.6712 (0.4); 2.6666 (0.3);
2.5247 (1.1); 2.5200 (1.6); 2.5113 (26.1); 2.5068 (54.9); 2.5022 (73.7); 2.4976 (53.4); 2.4931 (25.7);
2.3927 (12.4); 2.3337 (0.4); 2.3290 (0.5); 2.3245 (0.4); 2.2753 (0.4); 2.2187 (13.6); 1.3231 (12.8);
1.3111 (12.8); 1.2615 (6.2); 1.2495 (6.5); 1.2391 (2.1); 0.8534 (0.6); −0.0002 (7.5)
I-806: ¹H-NMR(400.2 MHz, d₆-DMSO):
δ = 9.3303 (1.2); 9.3150 (2.6); 9.2995 (1.3); 9.2552 (0.5); 7.9531 (1.5); 7.7273 (0.6); 7.7072 (0.6);
7.6911 (0.7); 7.6769 (1.4); 7.6575 (3.5); 7.6376 (2.8); 7.6066 (3.5); 7.5864 (1.8); 7.5766 (0.8); 7.5475
(0.4); 7.5271 (0.4); 7.4895 (4.1); 7.4709 (0.4); 7.4583 (2.3); 7.4390 (1.9); 7.3291 (0.6); 7.3089 (0.8);
7.2955 (3.6); 7.2755 (4.0); 7.2607 (0.4); 7.0628 (4.6); 6.8940 (2.6); 6.8741 (2.5); 6.5059 (2.6); 6.4817
(2.7); 5.9975 (1.2); 5.9835 (1.2); 5.9716 (1.3); 5.9573 (1.6); 5.9546 (1.6); 5.9403 (1.4); 5.9284 (1.4);
5.9144 (1.4); 5.5468 (0.4); 5.5423 (0.4); 5.1278 (3.3); 5.0815 (4.0); 5.0794 (4.1); 5.0529 (3.2); 4.4688
(0.7); 4.4530 (1.0); 4.4443 (0.8); 4.4389 (0.9); 4.4295 (1.0); 4.4146 (0.6); 4.1085 (0.8); 4.0994 (0.8);
4.0929 (0.8); 4.0688 (1.1); 4.0524 (1.0); 4.0312 (1.0); 4.0152 (0.9); 3.9946 (1.0); 3.9801 (1.0); 3.9556
(0.7); 3.9402 (0.7); 3.3593 (0.4); 3.3333 (170.3); 2.8906 (11.4); 2.7315 (9.9); 2.6714 (0.4); 2.6673
(0.3); 2.5249 (1.2); 2.5115 (27.1); 2.5071 (55.6); 2.5026 (73.7); 2.4981 (53.4); 2.4937 (26.0); 2.4097
(2.3); 2.3938 (11.5); 2.3339 (0.3); 2.3294 (0.5); 2.3251 (0.4); 2.2195 (16.0); 2.2095 (4.6); 2.0101
(0.4); 1.9910 (0.3); 1.6639 (0.8); 1.6519 (0.7); 1.2971 (11.0); 1.2808 (10.9); 1.2389 (2.3); 0.8533
(0.7); 0.8350 (0.4); −0.0002 (6.7)
I-807: ¹H-NMR(400.2 MHz, d₆-DMSO):
δ = 9.3075 (1.2); 9.2921 (2.7); 9.2766 (1.3); 7.6815 (1.2); 7.6618 (3.2); 7.6420 (2.6); 7.6106 (3.2);
7.5911 (1.6); 7.4796 (4.1); 7.4566 (2.4); 7.4368 (1.8); 7.2924 (3.7); 7.2723 (4.2); 7.0636 (4.3); 6.8940
(2.2); 6.8740 (2.0); 6.5587 (1.3); 6.5443 (2.7); 6.5300 (1.3); 4.1016 (1.0); 4.0863 (1.1); 4.0633 (2.3);
4.0478 (2.2); 4.0249 (1.2); 4.0098 (1.2); 3.5000 (2.8); 3.4860 (7.3); 3.4728 (4.6); 3.3821 (2.1); 3.3686
(5.0); 3.3547 (4.4); 3.3303 (80.8); 3.2705 (45.4); 2.8903 (0.8); 2.7308 (0.7); 2.6711 (0.4); 2.5248
(0.8); 2.5200 (1.3); 2.5113 (21.1); 2.5068 (43.7); 2.5023 (57.9); 2.4976 (41.6); 2.4931 (19.9); 2.3944
(11.3); 2.3291 (0.4); 2.2206 (16.0); 1.2581 (0.6); 1.2392 (2.1); 0.8530 (0.6); −0.0002 (5.6)
I-808: ¹H-NMR(400.2 MHz, d₆-DMSO):
δ = 9.2652 (0.4); 9.2498 (0.9); 9.2343 (0.4); 7.7487 (0.4); 7.7292 (1.1); 7.7097 (1.0); 7.6894 (1.2);
7.6696 (0.5); 7.5459 (1.5); 7.5352 (0.9); 7.5151 (0.6); 7.3142 (1.3); 7.2942 (1.4); 7.0642 (1.5); 6.8765
(0.8); 6.8565 (0.7); 4.1683 (0.4); 4.1531 (0.4); 4.1311 (0.8); 4.1156 (0.8); 4.0934 (0.4); 4.0781 (0.4);
3.5572 (1.6); 3.5422 (3.5); 3.5274 (1.9); 3.3344 (42.1); 3.2573 (1.8); 3.2426 (3.4); 3.2274 (2.0);
3.2225 (16.0); 2.8907 (0.7); 2.7312 (0.6); 2.5252 (0.4); 2.5204 (0.5); 2.5117 (7.3); 2.5073 (14.9);
2.5027 (19.6); 2.4981 (13.9); 2.4936 (6.6); 2.4088 (3.9); 2.2032 (5.6); 1.2392 (0.4); −0.0002 (2.2)
I-809: ¹H-NMR(400.2 MHz, d₆-DMSO):
δ = 9.2826 (1.3); 9.2671 (2.8); 9.2515 (1.3); 7.9532 (1.1); 7.6754 (1.2); 7.6558 (3.3); 7.6360 (2.6);
7.6030 (3.2); 7.5834 (1.7); 7.4741 (4.2); 7.4506 (2.4); 7.4309 (1.8); 7.2960 (3.8); 7.2760 (4.2); 7.0611
(4.3); 6.9000 (2.2); 6.8800 (2.0); 6.7211 (1.3); 6.7061 (2.7); 6.6911 (1.3); 4.0967 (1.0); 4.0818 (1.0);
4.0585 (2.3); 4.0431 (2.2); 4.0198 (1.2); 4.0044 (1.1); 3.3358 (155.7); 3.3197 (2.0); 3.3034 (3.5);
3.2839 (3.4); 3.2683 (1.6); 2.8907 (8.6); 2.7322 (6.9); 2.7313 (6.9); 2.6718 (0.4); 2.5253 (1.1); 2.5205
(1.7); 2.5119 (22.8); 2.5074 (46.6); 2.5028 (61.2); 2.4982 (43.3); 2.4937 (20.2); 2.3936 (11.2); 2.3296
(0.4); 2.2209 (16.0); 1.4994 (1.6); 1.4818 (3.8); 1.4637 (3.8); 1.4463 (1.6); 1.2391 (1.0); 0.6591 (0.4);
0.6461 (0.8); 0.6398 (0.8); 0.6281 (1.4); 0.6205 (0.8); 0.6155 (0.8); 0.6085 (1.0); 0.5965 (0.5); 0.5910
(0.4); 0.4191 (1.6); 0.4090 (4.2); 0.4047 (4.5); 0.3992 (2.0); 0.3949 (2.2); 0.3888 (4.1); 0.3847 (3.8);
0.3750 (1.4); 0.0637 (1.5); 0.0535 (4.6); 0.0501 (5.0); 0.0414 (4.5); 0.0379 (4.6); 0.0274
(1.2); −0.0002 (3.4)
I-810: ¹H-NMR(400.2 MHz, d₆-DMSO):
δ = 9.2694 (1.2); 9.2540 (2.7); 9.2385 (1.2); 9.0838 (0.6); 7.9529 (1.7); 7.7466 (1.0); 7.7271 (3.1);
7.7076 (3.1); 7.6916 (3.5); 7.6724 (1.5); 7.6536 (0.7); 7.6328 (0.6); 7.5994 (0.8); 7.5761 (4.2); 7.5474
(2.3); 7.5279 (1.8); 7.4040 (1.2); 7.3985 (1.1); 7.3925 (0.9); 7.3290 (3.7); 7.3091 (4.1); 7.2563 (0.9);
7.2364 (1.0); 7.1197 (1.3); 7.0678 (4.2); 7.0130 (1.0); 6.8918 (2.2); 6.8724 (2.0); 6.7571 (0.6); 6.7367
(0.5); 4.1519 (1.1); 4.1368 (1.1); 4.1149 (2.4); 4.0994 (2.4); 4.0775 (1.4); 4.0618 (1.4); 3.3303
(117.9); 2.8906 (13.6); 2.7311 (11.2); 2.6762 (0.3); 2.6714 (0.5); 2.6669 (0.4); 2.5249 (1.3); 2.5201
(1.9); 2.5115 (28.3); 2.5070 (58.8); 2.5024 (78.4); 2.4978 (56.5); 2.4933 (27.2); 2.4101 (11.1); 2.3754
(2.8); 2.3338 (0.4); 2.3292 (0.5); 2.3246 (0.4); 2.2082 (16.0); 2.1726 (4.1); 2.0101 (0.4); 1.9905 (0.4);
1.3758 (5.5); 1.2394 (2.3); 0.9374 (0.4); 0.9213 (1.3); 0.9092 (0.4); 0.8534 (0.8); 0.8354 (0.3); 0.6241
(0.4); 0.6117 (1.4); 0.6074 (1.4); 0.5947 (0.4); −0.0002 (6.9)
I-811: ¹H-NMR(400.2 MHz, d₆-DMSO):
δ = 9.3275 (1.2); 9.3121 (2.7); 9.2966 (1.3); 7.7662 (1.0); 7.7467 (3.2); 7.7272 (3.1); 7.7117 (3.6);
7.6920 (1.4); 7.5901 (4.1); 7.5686 (2.4); 7.5488 (1.8); 7.3232 (3.8); 7.3032 (4.2); 7.0711 (4.2); 6.8887
(2.2); 6.8693 (2.0); 4.1845 (1.1); 4.1688 (1.1); 4.1472 (2.4); 4.1316 (2.4); 4.1144 (2.0); 4.0898 (4.9);
4.0644 (4.8); 4.0390 (1.7); 3.3297 (88.3); 2.8906 (1.6); 2.7311 (1.4); 2.6714 (0.4); 2.5249 (0.9);
2.5202 (1.4); 2.5115 (23.2); 2.5070 (47.7); 2.5024 (63.0); 2.4978 (44.8); 2.4932 (21.1); 2.4151 (11.2);
2.3292 (0.4); 2.2064 (16.0); 1.2582 (0.5); 1.2393 (1.8); 0.8534 (0.6); −0.0002 (6.2)
I-812: ¹H-NMR(400.2 MHz, d₆-DMSO):
δ = 9.1373 (0.8); 9.1206 (1.4); 9.1023 (1.3); 9.0859 (0.5); 7.9530 (2.0); 7.6878 (0.5); 7.6791 (0.6);
7.6683 (1.5); 7.6606 (1.5); 7.6488 (1.2); 7.6394 (1.2); 7.6067 (2.1); 7.5869 (1.1); 7.4617 (1.8); 7.4574
(2.0); 7.4270 (5.1); 7.4094 (1.2); 7.2677 (3.1); 7.2477 (3.4); 7.0891 (1.8); 7.0833 (1.9); 7.0294 (3.4);
6.8122 (1.0); 6.7959 (1.8); 6.7784 (1.2); 6.6366 (1.2); 6.6289 (1.2); 4.2005 (0.3); 4.1796 (0.4); 4.1630
(0.3); 4.0972 (0.3); 4.0643 (0.6); 4.0278 (0.4); 4.0112 (0.4); 3.9396 (0.4); 3.9276 (0.4); 3.9025 (0.4);
3.8902 (0.4); 3.3564 (0.4); 3.3337 (127.1); 2.8905 (16.0); 2.7322 (13.0); 2.7310 (13.6); 2.7177 (0.8);
2.7102 (0.7); 2.7005 (0.4); 2.6716 (0.4); 2.5250 (1.0); 2.5203 (1.6); 2.5116 (23.7); 2.5072 (49.0);
2.5026 (64.8); 2.4980 (46.3); 2.4934 (21.9); 2.4636 (0.4); 2.4552 (0.8); 2.4471 (1.1); 2.4388 (1.1);
2.4308 (0.9); 2.4224 (0.4); 2.3795 (9.2); 2.3340 (0.3); 2.3294 (0.4); 2.1931 (8.0); 2.1868 (10.4);
1.2928 (0.3); 1.2766 (0.6); 1.2688 (0.8); 1.2574 (1.0); 1.2495 (0.8); 1.2400 (1.3); 1.0330 (0.4); 1.0221
(0.5); 1.0167 (0.5); 1.0108 (0.5); 1.0056 (0.4); 1.0002 (0.5); 0.9134 (0.5); 0.9015 (0.6); 0.8929 (1.1);
0.8807 (1.2); 0.8687 (0.9); 0.8597 (1.1); 0.8523 (0.6); 0.8476 (0.8); 0.8366 (0.5); 0.8265 (0.4); 0.6977
(0.4); 0.6827 (0.6); 0.6790 (0.6); 0.6637 (0.6); 0.6564 (0.5); 0.6419 (0.3); 0.6086 (0.6); 0.5990 (0.7);
0.5949 (0.8); 0.5851 (1.2); 0.5754 (0.7); 0.5713 (0.7); 0.5618 (0.6); 0.5012 (0.4); 0.4852 (0.7); 0.4757
(0.7); 0.4603 (0.4); 0.4498 (0.9); 0.4331 (1.6); 0.4268 (1.2); 0.4174 (1.7); 0.4025 (1.7); 0.3940 (0.9);
0.3905 (0.8); 0.3824 (1.2); 0.3738 (0.5); 0.3698 (0.6); 0.3619 (0.5); 0.3213 (0.5); 0.3127 (0.6); 0.3094
(0.6); 0.3006 (1.2); 0.2890 (0.9); 0.2796 (0.9); 0.2698 (0.7); 0.2659 (0.8); 0.2558 (0.5); 0.2457 (0.7);
0.2230 (0.3); 0.1302 (0.5); 0.1180 (1.8); 0.1071 (2.3); 0.1013 (1.5); 0.0983 (1.6); 0.0944 (1.5); 0.0856
(1.3); 0.0813 (0.8); 0.0737 (1.2); 0.0621 (1.2); 0.0527 (1.2); 0.0398 (0.8); 0.0297 (0.5); −0.0002 (6.0)
I-813: ¹H-NMR(400.2 MHz, d₆-DMSO):
δ = 9.1451 (1.1); 9.1295 (2.4); 9.1141 (1.2); 7.9524 (0.5); 7.8986 (15.0); 7.3328 (3.8); 7.3128 (4.4);
7.0904 (7.6); 7.0844 (4.7); 6.9946 (2.2); 6.9748 (2.0); 6.9253 (2.1); 6.9189 (1.9); 6.9039 (3.0); 6.8975
(2.9); 6.8186 (6.8); 6.7972 (4.6); 4.5992 (3.6); 4.5775 (7.7); 4.5557 (3.9); 4.1104 (1.2); 4.0946 (1.2);
4.0731 (2.8); 4.0573 (2.7); 4.0356 (1.4); 4.0200 (1.3); 3.3286 (51.8); 3.2374 (2.5); 3.2158 (5.0);
3.1941 (2.4); 2.8896 (4.1); 2.7313 (3.3); 2.7303 (3.4); 2.6706 (0.4); 2.5241 (1.0); 2.5194 (1.4); 2.5107
(21.6); 2.5062 (44.8); 2.5016 (58.9); 2.4970 (41.6); 2.4924 (19.5); 2.4188 (11.1); 2.3285 (0.4); 2.2637
(0.7); 2.2504 (16.0); 2.1999 (0.3); 1.2391 (1.3); 0.8533 (0.4); −0.0002 (5.0)
I-814: ¹H-NMR(400.2 MHz, d₆-DMSO):
δ = 9.1928 (1.1); 9.1772 (2.4); 9.1616 (1.2); 7.9417 (15.7); 7.4715 (2.5); 7.4519 (5.2); 7.4323 (3.4);
7.3201 (3.9); 7.3002 (4.4); 7.2487 (2.8); 7.2296 (2.4); 7.1809 (2.5); 7.1762 (4.0); 7.1724 (3.1); 7.1486
(2.4); 7.1446 (1.7); 7.1303 (2.0); 7.1286 (2.0); 7.1244 (1.6); 7.0817 (4.0); 6.9576 (2.1); 6.9376 (2.0);
4.4604 (15.8); 4.1138 (1.2); 4.0982 (1.2); 4.0769 (2.8); 4.0611 (2.7); 4.0397 (1.4); 4.0239 (1.3);
3.3287 (49.6); 3.3221 (51.8); 2.8896 (1.6); 2.7315 (1.2); 2.7302 (1.3); 2.6706 (0.4); 2.5242 (1.0);
2.5195 (1.4); 2.5108 (21.6); 2.5063 (44.9); 2.5017 (59.2); 2.4970 (41.6); 2.4924 (19.4); 2.4149 (11.1);
2.3284 (0.4); 2.2588 (0.5); 2.2328 (16.0); 2.1876 (0.3); 1.2387 (0.5); −0.0002 (6.2)
I-815: ¹H-NMR(400.2 MHz, d₆-DMSO):
δ = 9.2948 (1.1); 9.2791 (2.4); 9.2636 (1.2); 8.0705 (12.9); 7.9535 (1.6); 7.9497 (1.6); 7.9393 (1.4);
7.9344 (2.3); 7.9300 (1.7); 7.9196 (1.5); 7.9158 (1.5); 7.8298 (1.3); 7.8259 (1.3); 7.8095 (2.6); 7.8061
(2.4); 7.7897 (1.6); 7.7859 (1.4); 7.5670 (2.0); 7.5473 (3.5); 7.5266 (1.6); 7.3243 (3.8); 7.3043 (4.2);
7.0701 (4.1); 6.9341 (2.2); 6.9142 (2.0); 4.1354 (1.2); 4.1199 (1.2); 4.0986 (2.7); 4.0829 (2.6); 4.0615
(1.4); 4.0459 (1.3); 3.3295 (50.8); 2.8909 (3.1); 2.7312 (2.6); 2.6717 (0.4); 2.5253 (1.1); 2.5206 (1.6);
2.5118 (23.8); 2.5074 (49.0); 2.5028 (64.4); 2.4982 (45.7); 2.4937 (21.6); 2.4446 (0.4); 2.4206 (11.1);
2.3296 (0.4); 2.3056 (0.4); 2.2030 (16.0); 1.2386 (0.5); −0.0002 (6.0)
I-816: ¹H-NMR(400.2 MHz, d₆-DMSO):
δ = 9.2515 (1.1); 9.2362 (2.4); 9.2204 (1.1); 7.9787 (13.5); 7.9533 (0.6); 7.3265 (3.8); 7.3065 (4.2);
7.2731 (0.7); 7.2608 (1.6); 7.2500 (1.8); 7.2385 (1.4); 7.2333 (1.3); 7.2133 (1.1); 7.2024 (0.5); 7.1934
(8.0); 7.1810 (4.3); 7.1586 (0.5); 7.0735 (4.2); 6.9484 (2.2); 6.9282 (2.0); 4.1195 (1.2); 4.1039 (1.2);
4.0826 (2.7); 4.0669 (2.6); 4.0455 (1.4); 4.0298 (1.3); 3.3289 (54.6); 2.8903 (4.9); 2.7315 (4.2);
2.6710 (0.4); 2.5245 (1.3); 2.5197 (2.0); 2.5111 (26.1); 2.5067 (52.2); 2.5021 (67.2); 2.4975 (47.1);
2.4930 (22.0); 2.4199 (11.2); 2.3334 (0.4); 2.3287 (0.6); 2.3244 (0.4); 2.2973 (13.2); 2.2933 (13.1);
2.2659 (0.4); 2.2083 (16.0); 2.1847 (0.4); 1.2392 (1.2); 0.8535 (0.4); −0.0002 (5.4)
I-817: ¹H-NMR(400.2 MHz, d₆-DMSO):
δ = 9.1767 (0.8); 9.1610 (1.7); 9.1454 (0.8); 7.9321 (10.4); 7.3710 (1.5); 7.3516 (3.3); 7.3323 (2.0);
7.3239 (2.9); 7.3039 (3.2); 7.1239 (2.0); 7.1050 (1.9); 7.1035 (1.9); 7.0847 (3.1); 7.0209 (3.5); 7.0187
(4.2); 7.0173 (4.4); 6.9968 (1.5); 6.9913 (1.1); 6.9648 (1.6); 6.9452 (1.4); 4.1096 (0.9); 4.0939 (0.9);
4.0724 (2.0); 4.0567 (1.9); 4.0350 (1.0); 4.0193 (0.9); 3.3302 (41.6); 2.5243 (0.8); 2.5196 (1.2);
2.5109 (15.7); 2.5064 (32.4); 2.5018 (42.4); 2.4972 (29.7); 2.4926 (13.8); 2.4155 (8.2); 2.3460 (16.0);
2.3286 (0.4); 2.2906 (0.7); 2.2590 (0.4); 2.2378 (11.8); 1.2388 (0.4); −0.0002 (3.9)
I-818: ¹H-NMR(400.2 MHz, d₆-DMSO):
δ = 9.2533 (1.0); 9.2378 (2.2); 9.2221 (1.0); 7.9996 (16.0); 7.9530 (0.4); 7.3503 (0.4); 7.3448 (0.6);
7.3301 (2.2); 7.3241 (4.5); 7.3205 (6.2); 7.3104 (2.6); 7.3061 (5.8); 7.2982 (4.0); 7.2860 (1.5); 7.2026
(1.5); 7.1970 (1.5); 7.1842 (2.3); 7.1784 (1.2); 7.1742 (1.3); 7.1705 (1.1); 7.1602 (1.0); 7.0677 (3.7);
6.9327 (1.9); 6.9129 (1.7); 4.1220 (1.0); 4.1063 (1.0); 4.0853 (2.4); 4.0695 (2.3); 4.0483 (1.2); 4.0327
(1.1); 3.3279 (49.1); 2.8902 (3.2); 2.7308 (2.6); 2.6711 (0.4); 2.5450 (34.1); 2.5328 (0.5); 2.5247
(1.2); 2.5200 (1.7); 2.5112 (24.2); 2.5067 (50.0); 2.5021 (65.6); 2.4975 (46.0); 2.4929 (21.4); 2.4179
(9.8); 2.3289 (0.4); 2.3243 (0.4); 2.2911 (0.9); 2.2634 (0.4); 2.2036 (14.2); 2.1810 (0.4); 1.2392
(0.9); −0.0002 (5.2)
I-819: ¹H-NMR(400.2 MHz, d₆-DMSO):
δ = 9.1928 (1.2); 9.1773 (2.6); 9.1616 (1.4); 8.0040 (15.8); 7.9701 (0.4); 7.6858 (0.6); 7.6779 (5.7);
7.6756 (7.1); 7.6700 (3.1); 7.6666 (3.8); 7.6617 (5.2); 7.6469 (4.5); 7.6447 (4.4); 7.5353 (0.4); 7.5284
(0.5); 7.5239 (2.2); 7.5177 (2.3); 7.5163 (2.4); 7.5089 (2.9); 7.5040 (1.7); 7.5008 (1.8); 7.4949 (1.7);
7.4898 (0.5); 7.4844 (0.5); 7.3143 (3.7); 7.2943 (4.2); 7.0734 (4.1); 7.0422 (0.3); 6.9158 (2.2); 6.8955
(2.1); 4.1288 (1.2); 4.1133 (1.2); 4.0919 (2.8); 4.0761 (2.8); 4.0548 (1.6); 4.0391 (1.5); 3.3275 (51.3);
3.2943 (1.7); 2.8904 (1.2); 2.7308 (1.0); 2.6711 (0.4); 2.6666 (0.3); 2.5246 (1.4); 2.5199 (2.0); 2.5113
(24.4); 2.5067 (51.6); 2.5022 (69.5); 2.4976 (51.2); 2.4931 (26.2); 2.4725 (4.4); 2.4684 (4.7); 2.4130
(11.4); 2.3791 (1.0); 2.3336 (0.4); 2.3289 (0.5); 2.3244 (0.4); 2.2541 (0.4); 2.2173 (16.0); 2.1840
(1.0); 2.1719 (0.6); 1.2397 (0.7); −0.0002 (6.1)
I-820: ¹H-NMR(400.2 MHz, d₆-DMSO):
δ = 9.2935 (1.1); 9.2777 (2.4); 9.2621 (1.2); 8.0518 (15.6); 7.6121 (0.9); 7.5928 (1.8); 7.5813 (0.8);
7.5780 (1.0); 7.5747 (1.0); 7.5111 (0.7); 7.5062 (1.0); 7.4901 (2.8); 7.4852 (1.9); 7.4759 (3.1); 7.4708
(5.4); 7.4534 (2.2); 7.4500 (2.9); 7.4323 (0.7); 7.4291 (0.9); 7.3218 (3.9); 7.3018 (4.3); 7.0656 (4.1);
6.9185 (2.2); 6.8985 (2.0); 4.1328 (1.2); 4.1171 (1.2); 4.0960 (2.7); 4.0802 (2.6); 4.0591 (1.3); 4.0434
(1.3); 3.3287 (61.2); 3.3153 (0.5); 2.8907 (0.6); 2.7325 (0.6); 2.7312 (0.6); 2.6764 (0.4); 2.6718 (0.5);
2.6673 (0.4); 2.5254 (1.3); 2.5207 (1.8); 2.5120 (28.7); 2.5075 (60.2); 2.5029 (79.2); 2.4982 (55.7);
2.4936 (26.2); 2.4447 (0.3); 2.4203 (11.1); 2.3342 (0.4); 2.3297 (0.5); 2.3250 (0.4); 2.3053 (0.4);
2.2913 (1.0); 2.2622 (0.4); 2.1833 (16.0); 2.1662 (0.5); 1.2393 (0.6); −0.0002 (8.6)
I-821: ¹H-NMR(400.1 MHz, d₆-DMSO):
δ = 9.2640 (1.3); 9.2483 (2.7); 9.2330 (1.3); 7.9610 (0.8); 7.7298 (1.1); 7.7102 (3.0); 7.6907 (2.5);
7.6633 (3.4); 7.6438 (1.6); 7.5064 (5.2); 7.4831 (2.0); 7.3137 (3.5); 7.2938 (3.9); 7.0828 (4.4); 6.9059
(2.3); 6.8861 (2.1); 4.1787 (1.1); 4.1631 (1.1); 4.1409 (2.4); 4.1255 (2.3); 4.1028 (1.3); 4.0875 (1.2);
3.7048 (5.7); 3.6946 (8.0); 3.6833 (6.2); 3.3106 (88.4); 3.2029 (6.0); 3.1925 (7.8); 3.1817 (5.6);
2.8991 (5.2); 2.7400 (4.6); 2.5134 (17.5); 2.5090 (23.8); 2.5047 (17.7); 2.4199 (11.5); 2.2252 (16.0)
I-822: ¹H-NMR(400.1 MHz, CDCl3):
δ = 7.5593 (2.7); 7.3842 (0.6); 7.3799 (0.6); 7.3744 (1.4); 7.3633 (2.7); 7.3592 (3.0); 7.3534 (5.8);
7.3338 (2.3); 7.2620 (13.9); 7.2424 (1.2); 7.2141 (1.6); 7.2089 (2.7); 7.2038 (1.5); 7.0938 (1.2);
7.0899 (1.2); 7.0733 (1.1); 7.0695 (1.0); 6.4896 (0.5); 6.4746 (1.0); 6.4600 (0.6); 6.0175 (0.5); 6.0099
(0.6); 6.0000 (0.6); 5.9926 (0.6); 5.9011 (0.5); 5.8936 (0.6); 5.8837 (0.6); 5.8762 (0.6); 4.1748 (0.4);
4.1672 (0.4); 4.1582 (0.4); 4.1505 (0.4); 4.1449 (0.3); 4.1282 (0.3); 4.1079 (0.4); 4.1002 (0.4); 4.0914
(0.4); 4.0835 (0.4); 3.9012 (0.3); 3.8862 (0.5); 3.8691 (0.4); 3.8646 (0.3); 3.8464 (0.6); 3.8314 (0.7);
3.8137 (0.4); 3.8089 (0.4); 3.7916 (0.4); 2.5912 (0.8); 2.3878 (16.0); 1.5618 (12.8); 0.0078
(0.5); −0.0002 (15.9); −0.0080 (1.0)
I-823: ¹H-NMR(400.1 MHz, CDCl3):
δ = 8.1674 (0.8); 8.1538 (0.6); 8.1263 (5.4); 7.3095 (1.8); 7.2886 (2.2); 7.2613 (10.1); 7.1337 (0.4);
7.1193 (1.4); 7.1134 (2.6); 7.1104 (2.9); 7.0972 (3.3); 7.0765 (0.5); 6.9860 (3.3); 6.9712 (1.6); 6.8454
(0.7); 6.8394 (0.8); 6.8283 (1.2); 6.8170 (1.1); 6.8050 (0.6); 5.9525 (0.5); 5.9451 (0.6); 5.9322 (0.6);
5.9248 (0.6); 5.8336 (0.5); 5.8264 (0.6); 5.8134 (0.6); 5.8060 (0.6); 4.1666 (0.4); 4.1594 (0.4); 4.1496
(0.4); 4.1419 (0.4); 4.1105 (0.3); 4.0915 (0.4); 4.0837 (0.4); 4.0741 (0.4); 4.0666 (0.4); 3.7181 (0.3);
3.7064 (0.3); 3.6978 (0.3); 3.6855 (0.4); 3.6822 (0.4); 3.6721 (0.5); 3.6611 (0.7); 3.6511 (0.5); 3.6400
(0.4); 3.6367 (0.4); 3.6242 (0.3); 2.7170 (16.0); 2.7003 (0.6); 2.3769 (11.4); 2.2759 (10.0); 2.1247
(0.6); 2.1161 (0.7); 2.1034 (1.1); 2.0908 (0.7); 2.0824 (0.7); 2.0691 (0.3); 1.5709 (11.2); 1.0447 (0.6);
1.0331 (2.0); 1.0282 (2.1); 1.0172 (1.1); 1.0118 (2.2); 1.0070 (2.1); 0.9961 (1.0); 0.7945 (0.8); 0.7827
(2.4); 0.7790 (2.4); 0.7704 (2.2); 0.7661 (2.7); 0.7542 (0.8); 0.0078 (0.4); −0.0002 (12.6)
I-824: ¹H-NMR(400.1 MHz, CDCl3):
δ = 8.3031 (7.4); 7.7128 (1.0); 7.6163 (4.9); 7.6034 (3.7); 7.5823 (0.4); 7.3976 (2.7); 7.3439 (1.0);
7.3374 (1.2); 7.3298 (1.5); 7.3252 (1.3); 7.3152 (0.8); 7.2618 (12.2); 6.6697 (5.0); 3.7816 (1.5);
3.7654 (3.5); 3.7507 (3.6); 3.7345 (1.7); 2.8714 (2.5); 2.8549 (4.8); 2.8384 (2.5); 2.2429 (16.0);
2.0468 (15.9); 1.5656 (9.6); 0.0077 (0.5); −0.0002 (15.0)
I-825: ¹H-NMR(400.1 MHz, CDCl3):
δ = 8.2883 (15.7); 7.9302 (2.2); 7.9166 (1.4); 7.6655 (0.5); 7.6441 (5.8); 7.6312 (11.1); 7.5155 (5.3);
7.4623 (0.5); 7.4517 (2.0); 7.4421 (2.9); 7.4373 (3.0); 7.4295 (2.4); 7.4231 (1.8); 7.2619 (59.2);
6.9980 (0.3); 6.8755 (16.0); 4.3187 (2.8); 4.3033 (2.8); 4.2829 (5.9); 4.2675 (5.8); 4.2472 (3.1);
4.2318 (2.9); 3.4996 (0.4); 3.4873 (0.4); 1.5556 (79.0); 0.1459 (0.4); 0.0077 (2.7); −0.0002
(73.5); −0.0082 (4.4); −0.1496 (0.4)
I-826: ¹H-NMR(400.1 MHz, CDCl3):
δ = 8.3068 (8.2); 7.8236 (0.9); 7.6126 (5.1); 7.5998 (4.1); 7.5787 (0.5); 7.4070 (2.9); 7.3860 (1.2);
7.3795 (1.3); 7.3721 (1.6); 7.3673 (1.3); 7.3636 (1.1); 7.3572 (0.8); 7.2623 (14.8); 5.9076 (2.7);
5.9003 (3.0); 5.7056 (2.4); 5.7005 (2.4); 3.8262 (1.6); 3.8113 (3.8); 3.7957 (3.9); 3.7807 (1.9); 2.9354
(2.6); 2.9198 (4.4); 2.9042 (2.6); 2.1309 (0.5); 2.0537 (16.0); 1.5681 (9.6); 0.0077 (0.6); −0.0002
(18.3); −0.0082 (1.1)
I-827: ¹H-NMR(499.9 MHz, CDCl3):
δ = 8.1881 (0.4); 8.1776 (0.6); 8.1672 (0.4); 8.1009 (5.3); 7.4002 (1.8); 7.3845 (2.0); 7.2594 (5.4);
7.0849 (3.0); 7.0775 (1.6); 7.0755 (1.7); 7.0735 (1.8); 7.0702 (2.4); 7.0593 (0.4); 6.9616 (1.1); 6.9457
(1.0); 6.9309 (2.0); 6.8254 (0.6); 6.8176 (0.5); 6.8132 (0.9); 6.8063 (1.0); 6.7988 (0.5); 6.7932 (0.5);
5.2043 (0.7); 5.1971 (0.8); 5.1888 (0.8); 5.1816 (0.7); 3.9519 (0.6); 3.9446 (0.6); 3.9387 (0.6); 3.9313
(0.6); 3.9240 (0.7); 3.9167 (0.7); 3.9108 (0.7); 3.9034 (0.6); 3.5699 (0.6); 3.5601 (0.7); 3.5544 (0.7);
3.5444 (0.8); 3.5421 (0.7); 3.5322 (0.6); 3.5264 (0.6); 3.5165 (0.6); 2.6975 (16.0); 2.6821 (0.6);
2.5084 (0.4); 2.3593 (0.4); 2.3490 (11.1); 2.3137 (0.4); 2.2474 (10.1); 2.1044 (0.5); 2.0978 (0.5);
2.0942 (0.4); 2.0875 (1.0); 2.0808 (0.4); 2.0771 (0.6); 2.0705 (0.6); 1.6169 (0.3); 1.0312 (0.7); 1.0220
(1.8); 1.0182 (1.9); 1.0143 (1.0); 1.0093 (1.0); 1.0050 (1.9); 1.0012 (1.9); 0.9923 (0.9); 0.7807 (0.9);
0.7717 (2.1); 0.7681 (2.1); 0.7614 (2.0); 0.7579 (2.3); 0.7484 (0.9); −0.0002 (7.0)
I-828: ¹H-NMR(400.1 MHz, CDCl3):
δ = 8.8551 (0.5); 8.8400 (0.8); 8.8259 (0.5); 8.0806 (5.5); 7.3261 (1.9); 7.3061 (2.0); 7.2613 (12.1);
7.0875 (3.5); 6.9838 (2.1); 6.8512 (1.1); 6.8316 (1.1); 4.2419 (0.8); 4.2261 (0.9); 4.2069 (1.8); 4.1913
(1.8); 4.1719 (1.0); 4.1564 (0.9); 3.8375 (0.5); 3.7345 (16.0); 3.7001 (0.5); 2.9325 (0.8); 2.9136 (2.6);
2.8948 (2.7); 2.8847 (0.5); 2.8772 (1.0); 2.4723 (6.2); 2.3212 (0.3); 2.3054 (0.3); 2.2758 (8.5); 2.2216
(0.3); 1.5651 (5.0); 1.3977 (4.0); 1.3789 (8.2); 1.3600 (4.0); −0.0002 (0.4)
I-829: ¹H-NMR(400.1 MHz, CDCl3):
δ = 8.2655 (9.4); 8.0167 (2.2); 7.8915 (0.9); 7.8780 (1.5); 7.8644 (1.0); 7.3673 (1.4); 7.3607 (3.8);
7.3518 (3.4); 7.3402 (5.2); 7.3359 (4.5); 7.3184 (2.3); 7.2698 (2.6); 7.2619 (21.3); 7.2508 (3.4);
7.2298 (1.3); 7.0457 (4.0); 6.9913 (2.2); 6.9708 (2.0); 4.2628 (1.6); 4.2478 (1.6); 4.2269 (3.4); 4.2118
(3.4); 4.1909 (1.8); 4.1758 (1.8); 2.9569 (16.0); 2.8836 (14.8); 2.4870 (11.3); 2.4398 (0.4); 2.3118
(0.4); 2.2850 (15.9); 2.1706 (0.4); 1.7542 (1.8); 1.7409 (5.4); 1.7346 (5.8); 1.7222 (2.6); 1.6839 (0.3);
1.5741 (14.2); 1.5280 (0.6); 1.4900 (2.4); 1.4775 (5.7); 1.4711 (6.0); 1.4578 (2.3); −0.0002 (0.7)
I-830: ¹H-NMR(400.1 MHz, CDCl3):
δ = 8.3589 (1.3); 8.2560 (8.2); 8.0172 (2.2); 7.6923 (2.8); 7.6709 (3.0); 7.3363 (2.5); 7.3164 (2.8);
7.2672 (3.3); 7.2608 (16.4); 7.2550 (2.7); 7.2480 (2.9); 7.2411 (2.1); 7.0217 (3.0); 6.9485 (2.0);
6.9433 (2.0); 6.9272 (3.5); 6.9222 (2.6); 6.9081 (1.6); 6.5884 (2.2); 4.2465 (1.2); 4.2316 (1.2); 4.2103
(2.6); 4.1954 (2.5); 4.1741 (1.4); 4.1591 (1.3); 2.9554 (16.0); 2.8836 (14.5); 2.4698 (8.4); 2.2544
(11.7); 1.5822 (7.5); −0.0002 (0.5)
I-831: ¹H-NMR(400.1 MHz, CDCl3):
δ = 8.2563 (10.2); 8.0484 (1.4); 8.0348 (0.9); 8.0165 (0.7); 7.4838 (1.6); 7.4639 (3.4); 7.4440 (2.0);
7.3293 (3.5); 7.3094 (3.9); 7.2607 (20.5); 7.1594 (3.9); 7.1548 (3.5); 7.1457 (3.0); 7.1273 (4.2);
7.1247 (4.1); 7.1094 (2.2); 7.1038 (1.8); 7.0335 (4.0); 6.9485 (2.2); 6.9285 (2.0); 4.2441 (1.7); 4.2292
(1.7); 4.2081 (3.6); 4.1932 (3.6); 4.1721 (1.9); 4.1572 (1.8); 2.9564 (4.2); 2.8836 (3.8); 2.4715 (11.3);
2.4469 (0.7); 2.3288 (0.6); 2.2858 (16.0); 1.5927 (1.1); 1.5764 (4.2); 1.5723 (5.4); 1.5634 (12.1);
1.5479 (2.2); 1.5289 (3.4); 1.5253 (3.4); 1.5102 (1.3); 1.1504 (0.9); 1.1346 (3.1); 1.1307 (3.8); 1.1127
(3.8); 1.1090 (3.2); 1.0929 (0.9); −0.0002 (0.7)
I-832: ¹H-NMR(400.1 MHz, CDCl3):
δ = 8.2585 (10.6); 8.0161 (0.7); 7.8401 (0.8); 7.8271 (1.4); 7.3403 (3.4); 7.3204 (3.9); 7.2944 (0.5);
7.2789 (1.0); 7.2610 (24.7); 7.2432 (6.3); 7.2371 (3.4); 7.2268 (4.2); 7.2239 (3.8); 7.2152 (1.8);
7.2057 (1.0); 7.1972 (0.7); 7.0341 (4.0); 6.9544 (2.2); 6.9344 (2.0); 6.7779 (2.3); 6.5962 (4.7); 6.4145
(2.4); 4.2539 (1.8); 4.2389 (1.7); 4.2181 (3.8); 4.2031 (3.7); 4.1823 (2.0); 4.1673 (1.9); 2.9566 (5.4);
2.8835 (4.9); 2.4744 (11.5); 2.2767 (16.0); 1.5626 (16.6); 1.2539 (0.3); −0.0002 (0.7)
I-833: ¹H-NMR(400.1 MHz, CDCl3):
δ = 8.0085 (0.9); 7.4881 (0.9); 7.4848 (0.9); 7.4691 (1.5); 7.4529 (0.9); 7.3408 (2.3); 7.3208 (2.5);
7.2593 (32.9); 7.2413 (0.9); 7.2208 (1.7); 7.2035 (1.1); 7.1080 (1.2); 7.0876 (1.8); 7.0669 (0.8);
6.9204 (2.8); 6.8330 (1.5); 6.8112 (1.4); 6.3560 (0.6); 6.3417 (1.1); 4.2371 (1.1); 4.2209 (1.0); 4.2009
(2.2); 4.1853 (2.2); 4.1648 (1.1); 4.1494 (1.1); 2.9531 (5.7); 2.8790 (5.4); 2.4921 (7.7); 2.3525 (16.0);
1.8509 (0.7); 1.8423 (0.7); 1.8302 (1.2); 1.8182 (0.8); 1.8094 (0.6); 1.5469 (40.4); 1.0032 (0.8);
0.9910 (2.3); 0.9863 (2.4); 0.9701 (2.3); 0.9655 (2.2); 0.9545 (0.9); 0.6931 (0.9); 0.6808 (3.0); 0.6647
(2.9); 0.6523 (0.8); −0.0002 (33.7)
I-834: ¹H-NMR(400.1 MHz, CDCl3):
δ = 7.5593 (4.2); 7.3855 (0.6); 7.3614 (7.7); 7.3339 (2.8); 7.3296 (2.7); 7.3120 (1.9); 7.2667 (16.6);
7.2621 (17.0); 7.2265 (2.9); 7.2119 (5.0); 7.2081 (6.5); 7.0936 (2.3); 7.0743 (2.0); 7.0707 (2.0);
6.3833 (1.6); 6.3695 (1.0); 6.0169 (0.9); 6.0021 (0.9); 5.9018 (0.9); 5.8853 (0.9); 4.2190 (0.4); 4.2046
(0.4); 4.1825 (0.6); 4.1771 (0.5); 4.1654 (0.6); 4.1600 (0.6); 4.1543 (0.5); 4.1463 (0.4); 4.1343 (0.4);
4.1173 (0.5); 4.1096 (0.5); 4.1053 (0.5); 4.0998 (0.5); 3.8847 (0.4); 3.8713 (0.7); 3.8523 (0.7); 3.8334
(0.9); 3.8157 (1.0); 3.7972 (0.8); 3.7788 (0.7); 3.7656 (0.4); 2.6140 (14.8); 2.6101 (15.7); 2.5963
(1.3); 2.2966 (15.2); 2.2926 (16.0); 1.5665 (14.6); 0.0044 (20.9); −0.0002 (21.7)
I-835: ¹H-NMR(400.1 MHz, CDCl3):
δ = 8.0124 (1.6); 7.3736 (2.3); 7.3538 (2.6); 7.2598 (12.9); 7.1811 (2.8); 7.0761 (0.5); 7.0617 (1.8);
7.0535 (3.1); 7.0407 (3.8); 7.0232 (1.8); 7.0052 (1.5); 6.7808 (0.8); 6.7748 (0.9); 6.7637 (1.3); 6.7526
(1.2); 6.7405 (0.6); 6.4478 (0.6); 6.4329 (1.0); 6.4191 (0.6); 6.0609 (0.6); 6.0531 (0.6); 6.0444 (0.6);
6.0358 (0.6); 5.9444 (0.6); 5.9365 (0.6); 5.9272 (0.6); 5.9192 (0.6); 4.2177 (0.3); 4.2009 (0.3); 4.1897
(0.4); 4.1814 (0.4); 4.1731 (0.4); 4.1640 (0.5); 4.1524 (0.3); 4.1448 (0.3); 4.1361 (0.3); 4.1246 (0.4);
4.1161 (0.4); 4.1080 (0.4); 4.0997 (0.4); 3.9257 (0.4); 3.9114 (0.5); 3.8945 (0.4); 3.8897 (0.4); 3.8720
(0.7); 3.8577 (0.8); 3.8404 (0.4); 3.8355 (0.4); 3.8209 (0.4); 2.9526 (11.6); 2.8800 (10.8); 2.6145
(0.5); 2.5943 (15.8); 2.3432 (0.4); 2.3113 (16.0); 2.2938 (12.0); 2.0839 (0.6); 2.0756 (0.7); 2.0627
(1.2); 2.0498 (0.7); 2.0417 (0.7); 2.0283 (0.4); 1.5632 (8.6); 1.0081 (0.8); 0.9964 (2.2); 0.9916 (2.4);
0.9804 (1.3); 0.9752 (2.3); 0.9705 (2.3); 0.9595 (0.9); 0.7643 (1.0); 0.7526 (2.8); 0.7492 (2.7); 0.7402
(2.5); 0.7363 (2.8); 0.7240 (0.8); −0.0002 (17.5)
I-836: ¹H-NMR(400.1 MHz, CDCl3):
δ = 8.0117 (1.5); 7.2923 (2.2); 7.2728 (2.7); 7.2592 (14.9); 7.0851 (0.7); 7.0694 (1.6); 7.0651 (1.5);
7.0541 (3.6); 7.0482 (2.1); 7.0359 (2.6); 7.0142 (2.2); 6.9916 (2.0); 6.9819 (2.8); 6.7741 (1.0); 6.7702
(1.0); 6.7565 (1.4); 6.7513 (1.5); 6.7412 (0.8); 6.7344 (0.7); 6.5362 (0.6); 6.5213 (0.9); 5.9287 (0.6);
5.9213 (0.6); 5.9083 (0.6); 5.9005 (0.5); 5.8096 (0.6); 5.8022 (0.6); 5.7892 (0.6); 5.7819 (0.6); 4.1760
(0.3); 4.1505 (0.3); 4.1396 (0.4); 4.1317 (0.4); 4.1220 (0.4); 4.1143 (0.4); 4.1012 (0.3); 4.0831 (0.3);
4.0755 (0.3); 4.0649 (0.4); 4.0571 (0.4); 4.0469 (0.4); 4.0389 (0.4); 3.7304 (0.6); 3.7180 (0.4); 3.7102
(0.4); 3.6970 (0.5); 3.6862 (0.5); 3.6817 (0.4); 3.6738 (0.7); 3.6658 (0.4); 3.6530 (0.5); 3.6374 (0.3);
3.1676 (1.0); 2.9521 (10.8); 2.9224 (0.4); 2.8797 (10.1); 2.6033 (16.0); 2.5772 (1.3); 2.3719 (12.4);
2.3479 (1.6); 2.3372 (15.7); 2.3192 (2.1); 2.3112 (1.2); 2.2914 (12.0); 2.2313 (1.1); 2.0908 (0.5);
2.0781 (0.8); 2.0692 (0.8); 2.0568 (1.3); 2.0440 (0.8); 2.0359 (0.7); 2.0229 (0.4); 1.5691 (3.2); 1.0008
(0.8); 0.9891 (2.6); 0.9843 (2.6); 0.9731 (1.6); 0.9679 (2.6); 0.9632 (2.4); 0.9523 (1.0); 0.7570 (1.0);
0.7455 (3.1); 0.7330 (2.8); 0.7290 (3.0); 0.7168 (0.9); −0.0002 (19.8)
I-837: ¹H-NMR(400.1 MHz, CDCl3):
δ = 8.0122 (1.7); 7.3616 (2.4); 7.3415 (2.6); 7.2597 (14.0); 7.0783 (0.5); 7.0634 (2.1); 7.0546 (6.2);
7.0412 (3.4); 7.0204 (0.6); 6.9169 (1.7); 6.9133 (1.6); 6.8969 (1.5); 6.8933 (1.4); 6.7815 (0.8); 6.7756
(0.9); 6.7644 (1.3); 6.7530 (1.1); 6.7411 (0.6); 6.4433 (0.6); 6.4293 (1.0); 6.4152 (0.6); 6.0450 (0.6);
6.0369 (0.7); 6.0275 (0.6); 6.0192 (0.6); 5.9286 (0.6); 5.9202 (0.7); 5.9113 (0.7); 5.9031 (0.6); 4.2141
(0.3); 4.2052 (0.3); 4.1972 (0.3); 4.1856 (0.4); 4.1774 (0.4); 4.1694 (0.4); 4.1602 (0.5); 4.1489 (0.3);
4.1207 (0.4); 4.1120 (0.4); 4.1040 (0.4); 4.0955 (0.4); 3.9077 (0.4); 3.8914 (0.5); 3.8765 (0.4); 3.8716
(0.4); 3.8539 (0.7); 3.8398 (0.8); 3.8222 (0.4); 3.8174 (0.4); 3.8029 (0.4); 2.9524 (12.5); 2.8799
(11.6); 2.6115 (0.5); 2.5946 (16.0); 2.5778 (0.5); 2.3044 (16.0); 2.0869 (0.6); 2.0785 (0.7); 2.0657
(1.2); 2.0528 (0.7); 2.0444 (0.7); 2.0311 (0.4); 1.8638 (0.3); 1.8515 (0.7); 1.8429 (0.8); 1.8307 (1.3);
1.8182 (0.8); 1.8098 (0.7); 1.7972 (0.3); 1.5620 (12.5); 1.0075 (1.6); 0.9955 (4.5); 0.9909 (4.8);
0.9793 (2.6); 0.9744 (4.6); 0.9699 (4.4); 0.9588 (1.8); 0.7641 (1.0); 0.7525 (2.8); 0.7490 (2.7); 0.7398
(2.5); 0.7359 (2.9); 0.7237 (0.9); 0.6825 (1.0); 0.6706 (3.0); 0.6668 (2.7); 0.6584 (2.4); 0.6543 (3.0);
0.6421 (0.8); −0.0002 (18.8)
I-838: ¹H-NMR(400.1 MHz, CDCl3):
δ = 8.0109 (1.7); 7.4649 (2.4); 7.4448 (2.6); 7.2598 (15.7); 7.0706 (0.6); 7.0503 (2.0); 7.0379 (1.6);
7.0321 (4.0); 7.0213 (1.4); 7.0172 (1.5); 7.0014 (0.5); 6.9965 (0.4); 6.9500 (1.6); 6.9299 (1.4); 6.7850
(0.8); 6.7777 (0.8); 6.7684 (1.4); 6.7630 (1.2); 6.7494 (0.8); 6.7450 (0.7); 6.3862 (0.6); 6.3718 (1.1);
6.3559 (0.6); 4.4429 (1.1); 4.4269 (1.1); 4.4076 (2.4); 4.3916 (2.3); 4.3723 (1.2); 4.3563 (1.1); 2.9523
(12.0); 2.8794 (11.2); 2.5810 (16.0); 2.3677 (0.4); 2.2935 (11.0); 2.2626 (15.8); 2.1139 (0.4); 2.0815
(0.6); 2.0733 (0.7); 2.0605 (1.2); 2.0480 (0.7); 2.0394 (0.7); 1.5612 (12.7); 1.0155 (0.8); 1.0039 (2.3);
0.9991 (2.4); 0.9878 (1.3); 0.9826 (2.3); 0.9779 (2.3); 0.9670 (0.9); 0.7686 (1.0); 0.7570 (2.8); 0.7443
(2.5); 0.7405 (2.8); 0.7283 (0.8); −0.0002 (17.6)
I-839: ¹H-NMR(400.1 MHz, CDCl3):
δ = 8.0110 (0.9); 7.2969 (1.9); 7.2722 (1.0); 7.2592 (9.7); 7.1365 (1.5); 7.1168 (1.2); 7.0568 (0.4);
7.0360 (1.9); 7.0217 (2.5); 7.0113 (1.1); 6.7714 (0.5); 6.7554 (0.8); 6.7485 (0.9); 6.7366 (0.6); 6.7311
(0.5); 6.3902 (0.4); 6.3761 (0.7); 6.3619 (0.4); 4.2089 (0.8); 4.1934 (0.8); 4.1734 (1.7); 4.1578 (1.6);
4.1379 (0.8); 4.1224 (0.8); 2.9517 (6.7); 2.8790 (6.2); 2.5841 (11.4); 2.2861 (0.4); 2.2607 (11.5);
2.2415 (16.0); 2.0717 (0.4); 2.0633 (0.5); 2.0505 (0.9); 2.0378 (0.5); 2.0296 (0.5); 1.5567 (12.1);
1.0050 (0.6); 0.9933 (1.6); 0.9885 (1.7); 0.9774 (0.9); 0.9721 (1.6); 0.9674 (1.6); 0.9565 (0.7); 0.7573
(0.7); 0.7455 (2.0); 0.7421 (1.9); 0.7333 (1.8); 0.7291 (2.0); 0.7170 (0.6); −0.0002 (12.7)
I-840: ¹H-NMR(400.1 MHz, CDCl3):
δ = 8.0078 (1.7); 7.4864 (2.7); 7.4653 (2.3); 7.4452 (2.5); 7.2594 (15.7); 7.0899 (0.6); 7.0700 (1.8);
7.0504 (2.2); 7.0400 (1.4); 7.0245 (1.4); 7.0117 (1.7); 6.9930 (1.4); 6.8182 (0.8); 6.8131 (0.8); 6.8004
(1.4); 6.7824 (0.7); 6.4075 (0.6); 6.3927 (1.0); 6.3791 (0.6); 4.4663 (1.0); 4.4502 (1.0); 4.4310 (2.2);
4.4150 (2.1); 4.3957 (1.1); 4.3798 (1.0); 2.9518 (12.0); 2.8777 (11.2); 2.3774 (16.0); 2.2968 (10.1);
2.1532 (0.4); 2.0879 (0.6); 2.0791 (0.7); 2.0665 (1.1); 2.0541 (0.7); 2.0457 (0.6); 1.5487 (19.7);
1.0334 (0.7); 1.0218 (2.1); 1.0171 (2.2); 1.0056 (1.2); 1.0005 (2.2); 0.9959 (2.1); 0.9847 (0.8); 0.7782
(0.9); 0.7664 (2.6); 0.7539 (2.3); 0.7500 (2.6); 0.7377 (0.7); −0.0002 (21.0)
I-841: ¹H-NMR(400.1 MHz, CDCl3):
δ = 8.0093 (1.4); 7.4993 (0.8); 7.4820 (1.4); 7.4653 (0.9); 7.4311 (0.7); 7.4123 (1.5); 7.3932 (1.0);
7.3687 (2.3); 7.3489 (2.6); 7.3015 (1.3); 7.2815 (2.0); 7.2599 (12.6); 7.1850 (2.9); 7.0387 (1.6);
7.0190 (1.5); 7.0084 (1.3); 6.8713 (2.5); 6.7343 (1.2); 6.3729 (0.6); 6.3586 (1.0); 6.3445 (0.6); 6.0628
(0.6); 6.0544 (0.6); 6.0453 (0.6); 6.0368 (0.6); 5.9460 (0.6); 5.9378 (0.6); 5.9289 (0.6); 5.9204 (0.6);
4.2366 (0.3); 4.2285 (0.3); 4.2200 (0.3); 4.2115 (0.3); 4.2002 (0.4); 4.1916 (0.4); 4.1833 (0.4); 4.1746
(0.5); 4.1624 (0.3); 4.1541 (0.3); 4.1456 (0.3); 4.1345 (0.4); 4.1265 (0.4); 4.1179 (0.4); 4.1096 (0.4);
3.9208 (0.4); 3.9067 (0.5); 3.8890 (0.4); 3.8844 (0.4); 3.8674 (0.7); 3.8531 (0.8); 3.8359 (0.4); 3.8313
(0.4); 3.8168 (0.4); 2.9517 (10.0); 2.8781 (9.4); 2.6248 (0.5); 2.6021 (15.9); 2.5778 (0.3); 2.3459
(0.4); 2.3189 (16.0); 2.2906 (12.0); 1.5595 (10.2); −0.0002 (16.0)
I-842: ¹H-NMR(400.1 MHz, CDCl3):
δ = 8.0044 (1.7); 7.5028 (0.7); 7.4851 (1.3); 7.4686 (0.9); 7.3992 (3.2); 7.3815 (1.5); 7.3627 (1.0);
7.3412 (1.9); 7.3202 (3.1); 7.3066 (1.4); 7.2865 (1.9); 7.2598 (16.5); 7.2426 (1.0); 7.0059 (1.2);
6.8689 (2.5); 6.7319 (1.2); 6.3998 (0.6); 6.3846 (1.1); 6.3705 (0.6); 4.2520 (1.1); 4.2360 (1.1); 4.2158
(2.3); 4.1999 (2.2); 4.1799 (1.2); 4.1639 (1.1); 2.9509 (12.0); 2.8760 (11.1); 2.5972 (16.0); 2.5293
(7.6); 2.2469 (15.6); 1.5541 (20.1); −0.0002 (19.8)
I-843: ¹H-NMR(400.1 MHz, CDCl3):
δ = 7.9957 (1.4); 7.3385 (0.8); 7.3339 (0.8); 7.3153 (1.5); 7.3046 (0.9); 7.2905 (2.7); 7.2593 (12.1);
7.2432 (1.6); 7.1807 (0.5); 7.1760 (0.6); 7.1601 (1.7); 7.1554 (1.4); 7.1456 (4.1); 7.1427 (4.2); 7.1249
(2.7); 7.1016 (0.6); 6.3802 (0.6); 6.3657 (1.0); 6.3518 (0.6); 4.2067 (1.1); 4.1910 (1.1); 4.1712 (2.3);
4.1556 (2.2); 4.1357 (1.1); 4.1200 (1.1); 2.9492 (9.5); 2.8711 (8.9); 2.3722 (16.0); 2.2935 (0.4);
2.2798 (0.5); 2.2516 (13.2); 2.2432 (10.4); 1.5507 (14.3); −0.0002 (14.8)
I-844: ¹H-NMR(400.1 MHz, CDCl3):
δ = 7.9991 (1.8); 7.4917 (2.8); 7.4696 (2.4); 7.4495 (2.6); 7.3539 (0.7); 7.3497 (0.8); 7.3308 (1.4);
7.3199 (0.9); 7.3138 (0.8); 7.2597 (13.0); 7.1989 (0.5); 7.1954 (0.6); 7.1788 (1.6); 7.1744 (1.2);
7.1643 (1.7); 7.1589 (3.3); 7.1387 (1.6); 7.1186 (0.5); 7.0400 (1.5); 7.0201 (1.4); 6.3918 (0.6); 6.3774
(1.0); 6.3637 (0.6); 4.4648 (1.1); 4.4488 (1.1); 4.4292 (2.2); 4.4132 (2.1); 4.3936 (1.1); 4.3776 (1.1);
2.9502 (12.7); 2.8727 (12.0); 2.3893 (16.0); 2.3727 (0.5); 2.3061 (10.5); 2.1948 (0.4); 1.5515
(18.3); −0.0002 (17.3)

The compounds as shown in table 3, 5, 7 and 9 below were prepared in analogy with the examples provided above. ¹H-NMR data of these compounds is respectively shown in tables 4, 6, 8 and 10.

TABLE 3
Compounds according to formula (1)
(1)

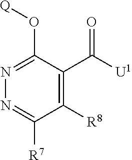

| Ex N^{o} | R⁷ | R⁸ | Q | U¹ | LogP |
|---|---|---|---|---|---|
| 1-001 | Cl | cyclopropyl | 3-(trifluoromethyl)phenyl | methoxy | 3.94^{[a]} |
| 1-002 | Cl | methyl | 3-chlorophenyl | hydroxy | 1.39^{[a]} |
| 1-003 | Cl | H | 3-(difluoromethyl)phenyl | hydroxy | 1.45^{[a]} |
| 1-004 | methylsulfanyl | H | 3-(trifluoromethyl)phenyl | hydroxy | 2.25^{[a]} |
| 1-005 | Cl | methyl | 3-cyclopropyl-2-fluorophenyl | hydroxy | 1.84^{[a]} |
| 1-006 | methyl | methyl | 3-(difluoromethyl)-2-fluorophenyl | methoxy | 2.64^{[a]} |
| 1-007 | cyano | H | 3-(trifluoromethyl)phenyl | hydroxy | 1.74^{[a]} |
| 1-008 | Cl | methyl | 3-(trifluoromethyl)phenyl | hydroxy | 1.70^{[a]} |
| 1-009 | methyl | methyl | 2-fluoro-3-(trifluoromethyl)phenyl | hydroxy | 1.40^{[a]} |
| 1-010 | methyl | H | 3-(difluoromethyl)-2-fluorophenyl | hydroxy | 1.34^{[a]} |
| 1-011 | Cl | H | 2,3-difluorophenyl | isopropyl- | 3.65^{[a]} |
| | | | | oxy | |
| 1-012 | cyclopropyl | H | 3-(difluoromethyl)phenyl | hydroxy | 1.68^{[a]} |
| 1-013 | methyl | methyl | 3-(difluoromethyl)-2-fluorophenyl | hydroxy | 0.96^{[a]} |
| 1-014 | Cl | cyclopropy- | 3-(trifluoromethyl)phenyl | hydroxy | 2.20^{[a]} |
| | | lamino | | | |
| 1-015 | Cl | H | 3-cyclopropylphenyl | hydroxy | 1.87^{[a]} |
| 1-016 | cyclopropyl | H | 3-(difluoromethyl)phenyl | isopropyl- | 3.63^{[a]} |
| | | | | oxy | |
| 1-017 | Cl | H | 3-ethynylphenyl | hydroxy | 1.50^{[a]} |
| 1-018 | methyl | methyl | 3-chlorophenyl | hydroxy | 0.80^{[a]} |
| 1-019 | methyl | H | 5-(trifluoromethyl)pyridin-3-yl | hydroxy | 1.01^{[a]} |
| 1-020 | 3-chloropyridin- | H | 3-(difluoromethyl)-2-fluorophenyl | hydroxy | 1.86^{[a]} |
| | 4-yl | | | | |
| 1-021 | pyrrolidin-1-yl | H | 3-(trifluoromethyl)phenyl | hydroxy | 1.08^{[a]} |
| 1-022 | cyano | H | 3-(trifluoromethyl)phenyl | isopropyl- | 3.85^{[a]} |
| | | | | oxy | |
| 1-023 | Cl | H | 3-(difluoromethyl)-2-fluorophenyl | isopropyl- | 3.68^{[a]} |
| | | | | oxy | |
| 1-024 | Cl | H | 2,3-difluorophenyl | hydroxy | 1.65^{[a]} |
| 1-025 | Cl | H | 5-(trifluoromethyl)pyridin-3-yl | hydroxy | 1.31^{[a]} |
| 1-026 | Cl | 2-methoxyethyl | 3-(trifluoromethyl)phenyl | hydroxy | 1.74^{[a]} |
| 1-027 | Cl | Cyclopropyl- | 3-(trifluoromethyl)phenyl | methoxy | 3.35^{[a]} |
| | | amino | | | |
| 1-028 | Cl | H | 3-cyclopropyl-2-fluorophenyl | hydroxy | 2.01^{[a]} |
| 1-029 | IH-imidazol-l- | H | 3-(trifluoromethyl)phenyl | hydroxy | 1.14^{[a]} |
| | yl | | | | |
| 1-030 | ethyl | H | 3-(trifluoromethyl)phenyl | hydroxy | 1.82^{[a]} |
| 1-031 | Cl | H | 6-(trifluoromethyl)pyridin-2-yl | hydroxy | 0.69^{[b]} |
| 1-032 | pyrrolidin-1-yl | H | 3-(trifluoromethyl)phenyl | isopropyl- | 3.62^{[a]} |
| | | | | oxy | |
| 1-033 | Cl | methyl | 3-chlorophenyl | methoxy | 3.37^{[a]} |
| 1-034 | acetyl | H | 3-(trifluoromethyl)phenyl | hydroxy | 2.01^{[a]} |
| 1-035 | ethyl | H | 3-(trifluoromethyl)phenyl | isopropyl- | 3.96^{[a]} |
| | | | | oxy | |
| 1-036 | methyl | H | 5-(trifluoromethyl)pyridin-3-yl | ethoxy | 2.37^{[a]} |
| 1-037 | methyl | methyl | 3-cyclopropylphenyl | hydroxy | 1.10^{[a]} |
| 1-038 | Cl | ethoxy | 3-(trifluoromethyl)phenyl | hydroxy | 1.96^{[a]} |
| 1-039 | vinyl | H | 3-(trifluoromethyl)phenyl | isopropyl- | 4.01^{[a]} |
| | | | | oxy | |
| 1-040 | methyl | H | 3-cyclopropylphenyl | hydroxy | 1.46^{[a]} |
| 1-041 | methyl | H | 2-fluoro-3-(trifluoromethyl)phenyl | methoxy | 2.90^{[a]} |
| 1-042 | methyl | methyl | 3-chlorophenyl | methoxy | 2.71^{[a]} |
| 1-043 | cyclopropyl | H | 3-(trifluoromethyl)phenyl | hydroxy | 1.90^{[a]} |
| 1-044 | Cl | H | 2-fluoro-3-(trifluoromethyl)phenyl | hydroxy | 1.98^{[a]} |
| 1-045 | Cl | H | 3-ethynylphenyl | isopropyl- | 3.64^{[a]} |
| | | | | oxy | |
| 1-046 | Cl | methoxy | 3-(trifluoromethyl)phenyl | methoxy | 3.52^{[a]} |
| 1-047 | Cl | H | 2-fluoro-3-(trifluoromethyl)phenyl | methoxy | 3.35^{[a]} |
| 1-048 | Cl | H | 3-bromophenyl | hydroxy | 1.66^{[a]} |
| 1-049 | Cl | Cl | 3-(trifluoromethyl)phenyl | methoxy | 3.86^{[a]} |
| 1-050 | IH-imidazol-l- | H | 3-(trifluoromethyl)phenyl | isopropyl- | 2.55^{[a]} |
| | yl | | | oxy | |
| 1-051 | Cl | H | 5-cyclopropylpyridin-3-yl | hydroxy | 0.59^{[b]} |
| 1-052 | Cl | I | 3-(trifluoromethyl)phenyl | methoxy | 3.25^{[a]} |
| 1-053 | 3-chloropyridin- | H | 2,3-difluorophenyl | hydroxy | 1.22^{[a]} |
| | 4-yl | | | | |
| 1-054 | ethyl | methyl | 3-(trifluoromethyl)phenyl | hydroxy | 1.54^{[a]} |
| 1-055 | Cl | Cl | 3-(difluoromethyl)-2-fluorophenyl | methoxy | 3.51^{[a]} |
| 1-056 | Cl | Cl | 3-cyclopropylphenyl | ethoxy | 4.41^{[a]} |
| 1-057 | trifluoromethyl | H | 3-(trifluoromethyl)phenyl | hydroxy | 2.27^{[a]} |
| 1-058 | Cl | H | 3-cyclopropyl-2-fluorophenyl | isopropyl- | 4.30^{[a]} |
| | | | | oxy | |
| 1-059 | trifluoromethyl | H | 3-(trifluoromethyl)phenyl | isopropyl- | 4.34^{[a]} |
| | | | | oxy | |
| 1-060 | Cl | ethoxy | 3-(trifluoromethyl)phenyl | ethoxy | 4.23^{[a]} |
| 1-061 | Cl | H | 3-cyclopropylphenyl | isopropyl- | 4.15^{[a]} |
| | | | | oxy | |
| 1-062 | Cl | H | 3-(difluoromethyl)-2-fluorophenyl | hydroxy | 1.63^{[a]} |
| 1-063 | Cl | H | 5-bromopyridin-3-yl | hydroxy | 0.94^{[a]} |
| | | | | | 0.53^{[b]} |
| 1-064 | Cl | Cl | 2-fluoro-3-(trifluoromethyl)phenyl | methoxy | 3.96^{[a]} |
| 1-065 | Cl | methyl | 3-cyclopropyl-2-fluorophenyl | isopropyl- | 4.51^{[a]} |
| | | | | oxy | |
| 1-066 | I | H | 3-(trifluoromethyl)phenyl | isopropyl- | 4.25^{[a]} |
| | | | | oxy | |
| 1-067 | methyl | H | 2-fluoro-3-(trifluoromethyl)phenyl | hydroxy | 1.75^{[a]} |
| 1-068 | cyclopropyl- | H | 3-(trifluoromethyl)phenyl | isopropyl- | 3.23^{[a]} |
| | amino | | | oxy | |
| 1-069 | Cl | vinyl | 3-(trifluoromethyl)phenyl | methoxy | 3.94^{[a]} |
| 1-070 | methyl | methyl | 3-(trifluoromethyl)phenyl | hydroxy | 1.52^{[a]} |
| 1-071 | Cl | H | 6-(trifluoromethyl)pyridin-2-yl | methoxy | 2.69^{[a]} |
| 1-072 | 1-ethoxy ethen- | H | 3-(trifluoromethyl)phenyl | isopropyl- | 4.90^{[a]} |
| | 1-yl | | | oxy | |
| 1-073 | Cl | Cl | 3-cyclopropyl-2-fluorophenyl | isopropyl- | 4.92^{[a]} |
| | | | | oxy | |
| 1-074 | 3-chloropyridin- | H | 2,3-difluorophenyl | isopropyl- | 3.65^{[a]} |
| | 4-yl | | | oxy | |
| 1-075 | acetyl | H | 3-(trifluoromethyl)phenyl | isopropyl- | 4.01^{[a]} |
| | | | | oxy | |
| 1-076 | Cl | H | 5-cyclopropylpyridin-3-yl | ethoxy | 2.60^{[b]} |
| 1-077 | methyl | methyl | 3-cyclopropyl-2-fluorophenyl | hydroxy | 1.31^{[a]} |
| 1-078 | Cl | methyl | 3-cyclopropylphenyl | isopropyl- | 4.41^{[a]} |
| | | | | oxy | |
| 1-079 | Cl | H | 3-(trifluoromethyl)phenyl | methoxy | 3.27^{[a]} |
| 1-080 | methyl | methyl | 3-cyclopropylphenyl | isopropyl- | 3.63^{[b]} |
| | | | | oxy | |
| 1-081 | Cl | methyl | 3-cyclopropylphenyl | hydroxy | 1.70^{[a]} |
| 1-082 | methyl | methyl | 3-(trifluoromethyl)phenyl | methoxy | 2.98^{[a]} |
| 1-083 | methylsulfanyl | H | 3-(trifluoromethyl)phenyl | ethoxy | 3.96^{[a]} |
| 1-084 | Cl | IH-pyrazol-l-yl | 3-(trifluoromethyl)phenyl | methoxy | 3.53^{[a]} |
| 1-085 | Cl | phenyl | 3-(trifluoromethyl)phenyl | methoxy | 4.25^{[a]} |
| 1-086 | Cl | H | 5-bromopyridin-3-yl | methoxy | 2.33^{[a]} |
| 1-087 | Cl | methyl | 3-(trifluoromethyl)phenyl | methoxy | 3.55^{[} |
| 1-088 | Cl | H | 5-(trifluoromethyl)pyridin-3-yl | ethoxy | 3.00^{[a]} |
| 1-089 | Cl | H | 2-fluoro-3-formylphenyl | isopropyl- | 3.19^{[a]} |
| | | | | oxy | |
| 1-090 | Cl | H | 2-fluoro-3-vinylphenyl | isopropyl- | 4.11^{[a]} |
| | | | | oxy | |
| 1-091 | Cl | H | 3-acetylphenyl | isopropyl- | 3.08^{[a]} |
| | | | | oxy | |
| 1-092 | Cl | H | 2-fluoro-3-vinylphenyl | hydroxy | 1.82^{[a]} |
| 1-093 | Cl | H | 3-acetylphenyl | hydroxy | 1.01^{[a]} |
| 1-094 | Cl | H | 3-[rac-2,2- | hydroxy | 1.87^{[a]} |
| | | | difluorocyclopropyl]phenyl | | |
| 1-095 | Cl | H | 3-(1-fluorocyclopropyl)phenyl | hydroxy | 1.82^{[a]} |
| 1-096 | Cl | H | 3-[rac-2,2- | isopropyl- | 3.96^{[a]} |
| | | | difluorocyclopropyl]phenyl | oxy | |
| 1-097 | Cl | H | 3-(1-fluorocyclopropyl)phenyl | isopropyl- | 3.99^{[a]} |
| | | | | oxy | |
| 1-098 | methyl | H | 3-(difluoromethyl)phenyl | hydroxy | 1.36^{[a]} |
| 1-099 | Cl | H | 3-cyclopropyl-2-fluorophenyl | methoxy | 3.45^{[a]} |
| 1-100 | methyl | H | 3-cyclopropyl-2-fluorophenyl | methoxy | 2.89^{[a]} |
| 1-101 | Cl | methyl | 3-cyclopropyl-2-fluorophenyl | methoxy | 3.70^{[a]} |
| 1-102 | Cl | H | 5-(difluoromethyl)pyridin-3-yl | isopropyl- | 2.82^{[a]} |
| | | | | oxy | |
| 1-103 | Cl | methyl | 3-[rac-2,2- | isopropyl- | 4.15^{[a]} |
| | | | difluorocyclopropyl]phenyl | oxy | |
| 1-104 | Cl | methyl | 3-(1-fluorocyclopropyl)phenyl | hydroxy | 1.63^{[a]} |
| 1-105 | Cl | methyl | 3-[rac-2,2- | hydroxy | 1.69^{[a]} |
| | | | difluorocyclopropyl]phenyl | | |
| 1-106 | Cl | methyl | 3-(1-fluorocyclopropyl)phenyl | isopropyl- | 4.25^{[a]} |
| | | | | oxy | |
| 1-107 | Cl | H | 2-fluoro-3-[rac-2,2- | isopropyl- | 3.96^{[a]} |
| | | | difluorocyclopropyl]phenyl | oxy | |
| 1-108 | Cl | H | 2-fluoro-3-[rac-2,2- | hydroxy | 1.81^{[a]} |
| | | | difluorocyclopropyl]phenyl | | |
| 1-109 | Cl | methyl | 2-fluoro-3-[rac-2,2- | isopropyl- | 4.23^{[a]} |
| | | | difluorocyclopropyl]phenyl | oxy | |
| 1-110 | Cl | methyl | 2-fluoro-3-[rac-2,2- | hydroxy | 1.82^{[a]} |
| | | | difluorocyclopropyl]phenyl | | |
| 1-111 | methyl | H | 3-cyclopropyl-2-fluorophenyl | hydroxy | 1.70^{[a]} |
| 1-112 | methyl | H | 3-cyclopropyl-2-fluorophenyl | ethoxy | 3.29^{[a]} |
| 1-113 | Cl | H | 2-fluoro-3-(l- | hydroxy | 1.99^{[a]} |
| | | | fluorocyclopropyl)phenyl | | |
| 1-114 | Cl | H | 2-fluoro-3-(l- | isopropyl- | 4.62^{[a]} |
| | | | fluorocyclopropyl)phenyl | oxy | |
| 1-115 | Cl | methyl | 2-fluoro-3-(l- | isopropyl- | 4.33^{[a]} |
| | | | fluorocyclopropyl)phenyl | oxy | |
| 1-116 | Cl | methylamino | 3-cyclopropyl-2-fluorophenyl | hydroxy | 1.97^{[a]} |
| 1-117 | Cl | methyl | 3-(difluoromethyl)-2-fluorophenyl | hydroxy | 1.49^{[a]} |
| 1-118 | Cl | H | 3-chloro-2-fluorophenyl | isopropyl- | 4.08^{[a]} |
| | | | | oxy | |
| 1-119 | Cl | H | 3-chloro-2-fluorophenyl | ethoxy | 3.60^{[a]} |
| 1-120 | methyl | H | 3-chloro-2-fluorophenyl | isopropyl- | 3.44^{[a]} |
| | | | | oxy | |
| 1-121 | Cl | methyl | 3-chloro-2-fluorophenyl | ethoxy | 3.88^{[a]} |
| 1-122 | Cl | methyl | 3-chloro-2-fluorophenyl | hydroxy | 1.68^{[a]} |
| 1-123 | methyl | H | 3-chloro-2-fluorophenyl | hydroxy | 1.46^{[a]} |
| 1-124 | Cl | H | 3-(difluoromethyl)phenyl | methoxy | 2.76^{[a]} |
| 1-125 | methyl | H | 3-(trifluoromethyl)phenyl | hydroxy | 1.92^{[a]} |
| 1-126 | methyl | H | 3-(trifluoromethyl)phenyl | methoxy | 2.77^{[a]} |
| 1-127 | I | H | 3-(trifluoromethyl)phenyl | hydroxy | 2.08^{[a]} |
| 1-128 | Cl | 2-methoxyethyl | 3-(trifluoromethyl)phenyl | methoxy | 3.54^{[a]} |
| 1-129 | H | H | 3-(trifluoromethyl)phenyl | hydroxy | 1.47^{[a]} |
| 1-130 | Cl | H | 3-bromophenyl | ethoxy | 3.65^{[a]} |

TABLE 4
1-001: ¹H-NMR(300.2 MHz, CDCl3):
δ = 7.6086 (1.0); 7.5857 (2.9); 7.5630 (4.8); 7.5094 (2.6); 7.4687 (1.6); 7.4604 (1.9); 7.4527 (1.3);
7.4386 (1.2); 7.3072 (2.2); 4.1198 (0.9); 4.1038 (4.6); 4.0794 (2.2); 4.0641 (16.0); 2.0544 (0.7);
2.0452 (0.7); 2.0348 (0.6); 2.0257 (1.3); 2.0166 (0.6); 2.0060 (0.8); 1.9969 (0.8); 1.9771 (0.4); 1.7052
(0.5); 1.2520 (1.0); 1.2311 (2.7); 1.2050 (2.6); 1.1848 (1.0); 1.1659 (0.3); 0.9016 (1.0); 0.8822 (3.0);
0.8638 (2.9); 0.8443 (0.7); 0.0432 (1.5)
1-002: ¹H-NMR(499.9 MHz, d₆-DMSO):
δ = 7.5070 (1.3); 7.4907 (2.9); 7.4745 (1.9); 7.3950 (1.2); 7.3909 (2.6); 7.3866 (1.8); 7.3766 (1.4);
7.3749 (1.6); 7.3727 (1.1); 7.3709 (1.0); 7.3605 (1.1); 7.3588 (1.1); 7.3566 (0.9); 7.3549 (0.8); 7.2279
(1.1); 7.2262 (1.2); 7.2234 (1.2); 7.2217 (1.1); 7.2115 (1.0); 7.2098 (1.0); 7.2069 (1.1); 7.2052 (0.9);
3.4043 (0.6); 3.3903 (1.0); 3.3763 (1.2); 3.3622 (1.5); 3.3227 (3.4); 2.5080 (5.7); 2.5044 (12.3);
2.5008 (17.2); 2.4972 (12.5); 2.4936 (5.9); 2.3962 (16.0); 2.3388 (0.8); 1.0907 (0.6); 0.0063
(0.3); −0.0002 (11.1); −0.0068 (0.4)
1-003: ¹H-NMR(400.1 MHz, d₆-DMSO):
δ = 8.2400 (16.0); 7.6498 (2.3); 7.6302 (5.4); 7.6106 (3.8); 7.5151 (4.9); 7.4824 (7.4); 7.4627 (4.5);
7.4423 (3.4); 7.2113 (3.0); 7.0721 (6.5); 6.9329 (3.2); 2.5098 (2.1)
1-004: ¹H-NMR(300.2 MHz, CDCl3):
δ = 7.9586 (5.4); 7.6341 (0.4); 7.6086 (1.4); 7.5827 (3.4); 7.5381 (2.1); 7.4940 (0.9); 7.4874 (1.4);
7.4806 (0.8); 7.4634 (0.9); 7.2986 (7.0); 2.7208 (16.0); 2.0934 (0.6); 1.2945 (1.0); 0.1080 (1.4);
0.0377 (7.1)
1-005: ¹H-NMR(499.9 MHz, d₆-DMSO):
δ = 7.2008 (0.5); 7.1974 (0.6); 7.1845 (1.3); 7.1815 (1.2); 7.1714 (1.3); 7.1667 (1.4); 7.1639 (2.1);
7.1483 (1.9); 7.1323 (0.7); 6.9341 (0.8); 6.9309 (0.8); 6.9188 (1.1); 6.9163 (1.2); 6.9061 (0.6); 6.9020
(0.5); 2.5135 (0.4); 2.5099 (0.5); 2.5063 (0.4); 2.3968 (16.0); 2.3846 (0.4); 2.0707 (0.6); 2.0641 (0.6);
2.0539 (1.1); 2.0436 (0.7); 2.0371 (0.6); 1.0253 (0.9); 1.0166 (2.2); 1.0122 (2.3); 1.0086 (1.3); 1.0039
(1.3); 0.9997 (2.2); 0.9953 (2.2); 0.9871 (0.9); 0.7823 (1.0); 0.7739 (2.4); 0.7720 (2.1); 0.7698 (2.5);
0.7637 (2.4); 0.7596 (2.5); 0.7507 (0.8)
1-006: ¹H-NMR(300.2 MHz, CDCl3):
δ = 7.5290 (0.6); 7.5080 (0.9); 7.4879 (0.9); 7.4660 (1.0); 7.4416 (0.7); 7.3266 (0.8); 7.2985 (5.1);
7.2731 (0.4); 7.0951 (0.8); 6.9124 (1.6); 6.7296 (0.8); 5.3346 (2.5); 4.0782 (0.4); 4.0489 (16.0);
4.0352 (0.3); 3.7395 (12.7); 2.6582 (11.6); 2.6276 (1.4); 2.4314 (1.4); 2.3595 (11.5); 1.2908 (0.4);
0.0358 (4.9)
1-007: ¹H-NMR(499.9 MHz, d₆-DMSO):
δ = 8.7747 (0.7); 8.6615 (16.0); 7.7649 (2.3); 7.7481 (11.4); 7.7336 (5.6); 7.7141 (6.8); 7.6986 (3.1);
7.6491 (4.7); 7.6326 (3.3); 6.9206 (1.2); 2.5059 (7.3); 2.5030 (9.5); 1.3543 (2.5); 1.3417 (2.3); 1.3262
(0.6); 1.3136 (0.7); 1.2963 (0.5); 1.2838 (0.5); 1.2584 (2.1); 1.2445 (2.1); 1.2355 (0.4); 1.1970 (4.6);
1.1837 (0.4); 1.1708 (4.7); 1.1593 (1.6); 1.1457 (1.5); 0.8848 (1.5); 0.8714 (1.5); −0.0002 (4.0)
1-008: ¹H-NMR(300.2 MHz, d₆-DMSO):
δ = 7.7747 (2.4); 7.7475 (8.1); 7.7204 (13.3); 7.7120 (13.1); 7.6924 (16.0); 7.6526 (0.5); 7.6169 (7.8);
7.5910 (5.1); 3.6770 (0.3); 3.6257 (0.3); 3.6165 (0.3); 3.5687 (0.4); 3.5321 (0.4); 3.4984 (0.4); 3.4631
(0.4); 3.4373 (0.4); 3.4027 (0.4); 3.3673 (0.4); 3.2814 (0.3); 3.2318 (0.3); 2.6507 (0.6); 2.5397 (13.4);
2.5340 (16.5); 2.4347 (75.8); 2.2151 (0.4); 2.1066 (1.0); 1.3861 (0.4); 1.2634 (1.1); 1.2122 (0.8);
0.0288 (8.6)
1-009: ¹H-NMR(300.2 MHz, d₆-DMSO):
δ = 14.8115 (0.3); 14.7538 (0.3); 14.6902 (0.4); 14.6014 (0.5); 14.5796 (0.7); 14.5446 (0.7); 14.4728
(0.9); 14.4307 (0.9); 14.4079 (0.9); 14.3765 (0.9); 14.3065 (0.6); 14.1519 (0.3); 14.1207 (0.4); 9.1033
(0.4); 8.0407 (1.1); 7.9545 (0.4); 7.8137 (7.8); 7.7870 (15.2); 7.7589 (14.7); 7.7529 (14.6); 7.7304
(9.1); 7.6828 (0.7); 7.6495 (0.8); 7.6320 (1.1); 7.6041 (1.3); 7.5547 (10.6); 7.5277 (16.0); 7.5005
(7.2); 7.4590 (0.8); 7.4324 (0.6); 7.4063 (0.3); 5.7771 (9.2); 4.0856 (0.8); 4.0616 (2.3); 4.0379 (2.4);
4.0143 (0.9); 3.9930 (0.7); 3.8624 (0.3); 3.8231 (0.4); 3.7943 (0.4); 3.5999 (1.0); 3.4738 (1.7); 3.4515
(1.7); 3.2850 (0.9); 3.2784 (0.9); 3.2157 (0.8); 3.1459 (0.5); 3.0680 (0.4); 2.7895 (0.6); 2.7555 (0.4);
2.6425 (2.5); 2.5763 (133.4); 2.5478 (10.4); 2.5344 (20.9); 2.5286 (40.2); 2.5226 (53.5); 2.5166
(39.7); 2.5108 (20.7); 2.4461 (1.7); 2.4317 (2.8); 2.4261 (2.1); 2.3921 (7.9); 2.3463 (134.0); 2.2794
(1.6); 2.2677 (1.7); 2.2250 (0.6); 2.2020 (0.8); 2.1764 (0.5); 2.1343 (1.0); 2.0990 (0.3); 2.0092 (9.8);
1.9298 (9.1); 1.3765 (0.6); 1.3450 (0.4); 1.2909 (0.7); 1.2568 (3.2); 1.2186 (3.1); 1.1948 (5.8); 1.1712
(2.8); 1.0760 (0.6); 0.8726 (0.7); 0.8511 (0.4); 0.0694 (4.6); 0.0303 (2.2); 0.0195 (50.2); −0.0400
(3.5); −0.1098 (0.4)
1-010: ¹H-NMR(300.2 MHz, d₆-DMSO):
δ = 14.2011 (0.4); 10.2674 (0.6); 8.9248 (2.2); 8.0180 (16.0); 7.9688 (0.4); 7.8521 (1.4); 7.7464 (0.5);
7.7246 (0.4); 7.7033 (0.4); 7.6763 (0.9); 7.6578 (2.1); 7.6321 (3.8); 7.6080 (3.8); 7.5862 (3.6); 7.5655
(2.3); 7.5330 (0.6); 7.5061 (1.3); 7.4754 (4.2); 7.4668 (4.6); 7.4489 (4.7); 7.4222 (1.9); 7.3531 (0.7);
7.3258 (1.0); 7.3083 (0.5); 7.2958 (1.3); 7.2866 (6.9); 7.1718 (1.3); 7.1445 (1.2); 7.1274 (1.8); 7.1065
(3.5); 7.0373 (0.3); 7.0178 (0.4); 7.0042 (0.5); 6.9905 (0.7); 4.0613 (0.8); 4.0375 (0.8); 3.7670 (0.4);
3.3472 (1.7); 2.7593 (4.4); 2.6359 (41.0); 2.5341 (6.7); 2.5282 (13.7); 2.5221 (18.8); 2.5160 (13.8);
2.5101 (6.7); 2.3931 (0.5); 2.3888 (0.5); 2.0089 (3.7); 1.9294 (9.0); 1.2184 (1.0); 1.1947 (2.0); 1.1710
(1.0); 0.0689 (7.2); 0.0306 (0.9); 0.0197 (20.4); 0.0087 (1.0)
1-011: ¹H-NMR(499.9 MHz, CDCl3):
δ = 7.9025 (16.0); 7.2682 (1.7); 7.1612 (0.4); 7.1501 (0.4); 7.1441 (1.2); 7.1418 (1.3); 7.1392 (0.7);
7.1350 (1.4); 7.1286 (5.4); 7.1224 (1.5); 7.1174 (5.0); 7.1116 (3.2); 7.1094 (3.4); 7.1055 (1.4); 7.1004
(3.8); 7.0977 (3.0); 7.0957 (2.6); 7.0911 (1.2); 7.0868 (1.2); 7.0829 (0.8); 7.0801 (1.0); 7.0759 (0.7);
5.3491 (1.2); 5.3365 (3.0); 5.3240 (4.0); 5.3115 (3.0); 5.2990 (1.2); 5.2957 (0.8); 1.6368 (0.3); 1.4341
(0.5); 1.4161 (42.0); 1.4035 (42.8); −0.0002 (1.8)
1-012: ¹H-NMR(300.2 MHz, d₆-DMSO):
δ = 14.0811 (0.4); 8.8902 (0.8); 7.9241 (16.0); 7.6373 (1.5); 7.6113 (3.6); 7.5856 (2.5); 7.5642 (0.4);
7.5453 (0.4); 7.4873 (3.3); 7.4616 (2.3); 7.3962 (7.2); 7.3700 (2.0); 7.3664 (2.2); 7.3624 (1.8); 7.2598
(2.6); 7.1170 (0.3); 7.0742 (5.6); 6.9478 (0.9); 6.9437 (0.6); 6.8886 (2.8); 3.3517 (1.0); 2.9129 (0.7);
2.7545 (0.6); 2.5366 (2.8); 2.5306 (6.0); 2.5245 (8.2); 2.5185 (5.9); 2.5125 (2.8); 2.3887 (0.6); 2.3720
(1.4); 2.3614 (1.5); 2.3565 (1.1); 2.3449 (2.5); 2.3394 (1.6); 2.3282 (1.5); 2.3177 (1.5); 2.3011 (0.8);
1.3786 (1.0); 1.1384 (1.3); 1.1215 (2.9); 1.1130 (5.3); 1.1031 (3.3); 1.0939 (3.0); 1.0854 (4.5); 1.0771
(3.2); 1.0613 (3.1); 1.0515 (4.9); 1.0434 (6.2); 1.0355 (5.0); 1.0268 (4.0); 1.0092 (1.0); 0.0328 (0.4);
0.0220 (9.4); 0.0110 (0.4); −0.0377 (0.5)
1-013: ¹H-NMR(300.2 MHz, d₆-DMSO):
δ = 19.2951 (0.4); 14.7822 (0.4); 14.6202 (0.4); 14.5848 (0.5); 14.5179 (0.6); 14.3702 (0.8); 14.3517
(0.7); 14.1893 (0.4); 9.0845 (0.4); 7.8097 (0.4); 7.7436 (1.0); 7.6771 (2.0); 7.6436 (4.9); 7.6131
(12.1); 7.5875 (12.2); 7.5658 (5.6); 7.4690 (10.2); 7.4603 (9.4); 7.4436 (10.6); 7.4165 (4.0); 7.3482
(0.5); 7.3176 (0.8); 7.3055 (1.9); 7.2939 (3.5); 7.2801 (16.0); 7.1254 (0.9); 7.1135 (1.6); 7.1000 (7.8);
4.0617 (0.7); 4.0382 (0.7); 3.9452 (0.4); 3.8251 (0.8); 3.7670 (0.4); 3.7152 (0.4); 3.6224 (1.0); 3.5890
(1.2); 3.3665 (6.5); 3.1389 (0.8); 3.0599 (0.6); 3.0068 (0.4); 2.9597 (0.5); 2.9355 (0.4); 2.7846 (0.5);
2.7489 (0.6); 2.6828 (6.6); 2.6379 (0.6); 2.5709 (87.4); 2.5342 (30.6); 2.5282 (63.1); 2.5222 (86.3);
2.5161 (63.2); 2.5102 (30.7); 2.4628 (1.3); 2.4391 (11.3); 2.4239 (9.3); 2.3839 (2.0); 2.3388 (86.0);
2.2941 (1.3); 2.2557 (1.8); 2.1740 (0.4); 2.1268 (0.6); 2.0094 (2.9); 1.9296 (0.4); 1.7920 (0.4); 1.7800
(0.6); 1.2193 (0.9); 1.1954 (1.6); 1.1715 (0.7); 0.0316 (2.6); 0.0208 (75.5); 0.0098 (3.6); −0.0348
(0.4); −0.1782 (0.4); −2.4204 (0.4); −3.4823 (0.4)
1-014: ¹H-NMR(300.2 MHz, CDCl3):
δ = 7.6445 (0.5); 7.5698 (2.7); 7.5445 (7.8); 7.5195 (16.0); 7.5093 (9.8); 7.4764 (11.2); 7.4396 (5.2);
7.4332 (8.1); 7.4263 (4.2); 7.4086 (5.5); 7.3826 (0.6); 7.3637 (0.7); 7.3254 (0.6); 7.3137 (0.6); 7.2986
(53.8); 7.2646 (0.4); 6.2623 (0.4); 6.1844 (3.5); 6.0638 (0.7); 6.0086 (0.3); 4.1995 (0.8); 4.1756 (2.3);
4.1519 (2.3); 4.1283 (0.8); 3.9955 (1.5); 3.7885 (5.4); 2.9593 (1.0); 2.9468 (2.0); 2.9363 (3.0); 2.9243
(4.0); 2.9173 (4.2); 2.9054 (2.9); 2.8954 (2.1); 2.8833 (1.1); 2.1754 (0.6); 2.0898 (11.2); 1.3210 (2.9);
1.2972 (5.9); 1.2734 (2.9); 1.2573 (0.8); 1.0060 (0.5); 0.9871 (0.6); 0.9703 (0.5); 0.9336 (2.4); 0.9096
(10.1); 0.8908 (10.0); 0.8686 (4.7); 0.8384 (1.8); 0.8233 (1.3); 0.8183 (1.3); 0.7839 (4.0); 0.7680
(10.0); 0.7601 (11.9); 0.7312 (2.6); 0.0482 (1.6); 0.0450 (0.8); 0.0374 (52.7); 0.0282 (1.7); 0.0265 (2.1)
1-015: ¹H-NMR(300.2 MHz, d₆-DMSO):
δ = 8.2130 (16.0); 7.3593 (2.5); 7.3332 (5.6); 7.3070 (3.4); 7.0221 (3.3); 7.0179 (3.1); 7.0083 (2.7);
7.0051 (2.6); 7.0002 (5.0); 6.9971 (5.0); 6.9819 (1.8); 6.9786 (1.8); 6.9739 (3.5); 6.9708 (2.8); 6.9607
(4.6); 6.9548 (5.0); 6.9484 (2.6); 5.7756 (1.8); 2.5344 (1.4); 2.5284 (3.0); 2.5223 (4.1); 2.5162 (3.0);
2.5103 (1.4); 2.0139 (0.6); 2.0090 (0.4); 1.9970 (1.2); 1.9859 (1.4); 1.9807 (1.0); 1.9693 (2.6); 1.9578
(1.0); 1.9524 (1.5); 1.9414 (1.4); 1.9245 (0.7); 1.0128 (1.6); 0.9983 (4.4); 0.9908 (4.9); 0.9852 (2.4);
0.9772 (2.6); 0.9702 (4.7); 0.9628 (4.5); 0.9494 (2.0); 0.7347 (2.0); 0.7209 (5.0); 0.7178 (4.2); 0.7139
(5.2); 0.7044 (4.8); 0.6974 (5.3); 0.6822 (1.6); 0.0194 (4.1)
1-016: ¹H-NMR(300.2 MHz, CDCl3):
δ = 7.6954 (5.4); 7.5477 (0.5); 7.5212 (1.3); 7.4941 (1.1); 7.4005 (1.2); 7.3983 (1.2); 7.3790 (2.2);
7.3462 (0.6); 7.3427 (0.7); 7.3391 (0.6); 7.2996 (2.6); 6.8673 (0.9); 6.6792 (1.9); 6.4912 (1.0); 5.3799
(0.5); 5.3589 (1.0); 5.3380 (1.4); 5.3172 (1.0); 5.2963 (0.4); 2.2223 (0.5); 2.2117 (0.6); 2.2003 (0.6);
2.1954 (0.9); 2.1838 (0.4); 2.1787 (0.6); 2.1681 (0.6); 1.6222 (2.1); 1.4442 (1.0); 1.4263 (16.0);
1.4054 (15.6); 1.2507 (0.4); 1.2320 (1.4); 1.2236 (1.7); 1.2147 (2.4); 1.2073 (1.6); 1.1971 (1.0);
1.1927 (0.7); 1.1785 (1.4); 1.1692 (1.7); 1.1609 (1.2); 1.1566 (0.8); 1.1520 (1.1); 1.1419 (2.0); 1.1334
(1.1); 1.1154 (0.4); 0.0373 (2.2)
1-017: ¹H-NMR(300.2 MHz, d₆-DMSO):
δ = 8.2024 (15.4); 7.5239 (2.4); 7.4978 (6.6); 7.4717 (5.7); 7.4224 (6.0); 7.4182 (4.4); 7.3968 (3.8);
7.3878 (4.6); 7.3809 (6.0); 7.3392 (3.5); 7.3355 (3.7); 7.3314 (3.0); 7.3276 (2.6); 7.3125 (2.6); 7.3085
(2.5); 7.3048 (2.4); 7.3008 (1.9); 4.3136 (16.0); 4.1188 (0.4); 4.0607 (0.7); 4.0373 (0.7); 3.4742 (0.5);
3.4406 (0.9); 3.3535 (3.2); 3.1825 (0.4); 3.1706 (0.4); 2.5342 (10.6); 2.5282 (23.5); 2.5222 (33.0);
2.5162 (24.2); 2.5103 (11.6); 2.0095 (3.2); 1.9291 (0.5); 1.2183 (0.8); 1.1947 (1.7); 1.1710 (0.8);
0.0311 (1.0); 0.0202 (37.5); 0.0092 (1.5)
1-018: ¹H-NMR(499.9 MHz, d₆-DMSO):
δ = 7.4874 (1.5); 7.4711 (3.3); 7.4548 (2.0); 7.3409 (1.4); 7.3383 (1.7); 7.3224 (1.5); 7.3033 (1.9);
7.2990 (3.2); 7.2949 (1.8); 7.1631 (1.4); 7.1596 (1.4); 7.1467 (1.3); 7.1433 (1.3); 3.3599 (0.4); 2.5688
(16.1); 2.5531 (0.8); 2.5119 (2.6); 2.5084 (3.7); 2.5049 (2.9); 2.3225 (0.7); 2.3090 (16.0); 2.2943 (0.8)
1-019: ¹H-NMR(300.2 MHz, d₆-DMSO):
δ = 14.1821 (0.3); 14.1522 (0.3); 14.1295 (0.3); 8.9947 (1.3); 8.9712 (0.5); 8.9384 (1.4); 8.9245 (6.4);
8.8856 (5.5); 8.8774 (5.5); 8.4370 (0.6); 8.3456 (0.6); 8.2841 (3.7); 8.2778 (5.8); 8.0392 (16.0);
7.8389 (1.1); 7.4574 (1.0); 6.5531 (0.6); 5.7793 (0.7); 3.3463 (8.6); 3.2149 (0.4); 3.1782 (0.4); 2.7764
(3.8); 2.7504 (0.4); 2.6563 (42.8); 2.5927 (0.5); 2.5359 (14.6); 2.5300 (31.2); 2.5239 (42.6); 2.5179
(30.6); 2.5121 (14.3); 2.4565 (0.4); 2.3903 (3.1); 1.2565 (1.1); 1.1966 (0.4); 0.0697 (5.9); 0.0328
(0.9); 0.0220 (28.2); 0.0111 (1.0)
1-020: ¹H-NMR(300.2 MHz, d₆-DMSO):
δ = 8.9251 (0.3); 8.8698 (3.6); 8.7342 (2.5); 8.7177 (2.6); 8.5006 (5.4); 8.2939 (0.9); 8.0718 (0.4);
7.7863 (2.6); 7.7700 (2.3); 7.7560 (1.1); 7.7298 (0.6); 7.6669 (0.5); 7.6453 (1.1); 7.6245 (0.9); 7.5292
(1.0); 7.5046 (2.3); 7.4765 (0.8); 7.3255 (2.1); 7.3014 (0.4); 7.1455 (1.2); 7.1278 (0.4); 5.7769 (0.3);
3.5887 (0.6); 3.3438 (0.8); 2.5345 (3.5); 2.5286 (7.4); 2.5226 (10.2); 2.5166 (7.6); 2.5108 (3.7);
2.0095 (0.4); 1.9298 (1.9); 1.1796 (2.6); 1.0901 (16.0); 0.0313 (0.4); 0.0205 (11.3); 0.0096
(0.6); −0.0417 (0.4)
1-021: ¹H-NMR(300.2 MHz, d₆-DMSO):
δ = 7.6610 (1.6); 7.6347 (4.1); 7.6081 (3.1); 7.5426 (3.9); 7.5167 (2.4); 7.4043 (5.0); 7.3769 (3.1);
7.3499 (2.4); 7.2994 (11.4); 4.0839 (0.8); 4.0603 (2.5); 4.0366 (2.6); 4.0129 (0.9); 3.5091 (5.2);
3.4874 (13.6); 3.4658 (5.4); 3.3528 (4.0); 2.5338 (5.3); 2.5280 (10.8); 2.5220 (14.6); 2.5160 (10.6);
2.5102 (5.0); 2.0160 (5.6); 2.0088 (16.0); 1.9945 (14.2); 1.9725 (5.0); 1.9290 (8.8); 1.4024 (0.7);
1.3815 (0.6); 1.2529 (0.5); 1.2177 (3.0); 1.1940 (5.9); 1.1703 (2.9); 0.0298 (0.6); 0.0191 (14.1);
0.0083 (0.7); −0.0416 (3.6)
1-022: ¹H-NMR(300.2 MHz, CDCl3):
δ = 8.2527 (16.0); 7.8756 (2.0); 7.6838 (1.0); 7.6576 (4.6); 7.6377 (12.0); 7.6350 (10.4); 7.6223 (1.5);
7.5542 (5.6); 7.5276 (0.9); 7.5211 (0.8); 7.5111 (2.5); 7.5013 (3.8); 7.4938 (3.0); 7.4806 (2.6); 7.4730
(1.7); 7.3057 (4.7); 5.4583 (0.6); 5.4357 (1.6); 5.4146 (3.4); 5.3937 (4.4); 5.3728 (3.2); 5.3519 (1.3);
1.6910 (0.4); 1.6701 (0.6); 1.6389 (2.2); 1.5343 (6.3); 1.5134 (6.6); 1.4809 (47.7); 1.4601 (47.0);
1.2978 (0.3); 0.0405 (3.2)
1-023: ¹H-NMR(300.2 MHz, CDCl3):
δ = 7.9376 (5.4); 7.6355 (0.5); 7.5766 (0.4); 7.5552 (0.8); 7.5345 (0.5); 7.5325 (0.5); 7.5089 (0.4);
7.5061 (0.4); 7.4818 (0.9); 7.4792 (0.8); 7.4575 (0.6); 7.4549 (0.6); 7.3709 (0.8); 7.3437 (1.2); 7.3177
(0.4); 7.2984 (2.8); 7.1103 (0.9); 6.9278 (1.8); 6.7452 (0.9); 5.4078 (0.4); 5.3870 (1.0); 5.3661 (1.3);
5.3452 (1.0); 5.3244 (0.4); 1.6170 (0.8); 1.4798 (1.5); 1.4609 (16.0); 1.4400 (15.1); 1.4256 (0.5);
1.4046 (0.4); 1.2465 (0.4); 0.0361 (2.9)
1-024: ¹H-NMR(400.2 MHz, d₆-DMSO):
δ = 8.2813 (16.0); 7.4772 (0.6); 7.4716 (0.7); 7.4577 (1.4); 7.4525 (1.7); 7.4352 (1.9); 7.4272 (1.3);
7.4142 (1.0); 7.4089 (0.9); 7.3620 (0.8); 7.3584 (0.7); 7.3477 (0.8); 7.3409 (1.9); 7.3374 (2.0); 7.3258
(2.9); 7.3189 (4.4); 7.3098 (4.5); 7.3022 (2.6); 7.2816 (0.8); 2.5267 (0.6); 2.5220 (0.8); 2.5131 (5.9);
2.5087 (12.3); 2.5042 (16.8); 2.4997 (12.2); 2.4953 (6.0); −0.0013 (1.4); −0.0026 (1.2)
1-025: ¹H-NMR(300.2 MHz, d₆-DMSO):
δ = 8.9709 (1.1); 8.9573 (4.6); 8.9551 (4.7); 8.9438 (4.4); 8.9353 (4.3); 8.4460 (0.3); 8.4354 (0.4);
8.4252 (0.5); 8.4165 (0.5); 8.3716 (2.7); 8.3654 (4.6); 8.3587 (2.7); 8.3239 (16.0); 8.0825 (1.7);
5.7786 (1.2); 4.0633 (0.4); 4.0395 (0.4); 3.6458 (0.4); 3.5738 (0.6); 3.5399 (0.7); 3.3575 (4.7); 3.0447
(1.0); 2.5362 (8.2); 2.5302 (18.1); 2.5241 (25.4); 2.5180 (18.5); 2.5120 (8.8); 2.0111 (1.8); 1.2566
(0.4); 1.2206 (0.4); 1.1969 (1.0); 1.1731 (0.5); 0.0330 (0.8); 0.0221 (26.6); 0.0112 (1.0)
1-026: ¹H-NMR(300.2 MHz, CDCl3):
δ = 7.5917 (1.2); 7.5687 (5.0); 7.5142 (1.0); 7.5064 (1.4); 7.4985 (0.8); 7.4841 (0.7); 7.2987 (9.1);
3.9135 (1.8); 3.8940 (3.9); 3.8743 (2.3); 3.5053 (16.0); 3.2649 (2.1); 3.2454 (3.8); 3.2259 (2.1);
1.2932 (0.8); 1.1443 (0.6); 0.0373 (7.8)
1-027: ¹H-NMR(300.2 MHz, CDCl3):
δ = 7.5541 (0.4); 7.5433 (0.9); 7.5165 (2.2); 7.5102 (1.3); 7.4902 (1.5); 7.4883 (1.4); 7.4831 (1.6);
7.4402 (0.7); 7.4327 (1.2); 7.4255 (0.6); 7.4169 (0.4); 7.4144 (0.4); 7.4090 (0.6); 7.4018 (0.3); 7.2985
(2.8); 5.6931 (0.8); 4.0184 (1.9); 4.0071 (0.4); 3.9923 (16.0); 2.7929 (0.4); 2.7891 (0.4); 2.7825 (0.4);
2.7771 (0.6); 2.7705 (0.7); 2.7651 (0.5); 2.7585 (0.4); 2.7550 (0.4); 2.7483 (0.4); 2.0802 (0.7); 1.6331
(0.7); 1.2941 (0.4); 0.8795 (1.4); 0.8742 (0.9); 0.8618 (1.4); 0.8570 (1.2); 0.8517 (0.9); 0.8395 (0.7);
0.8107 (0.4); 0.7720 (0.7); 0.7589 (1.5); 0.7490 (1.5); 0.7455 (1.5); 0.7325 (0.8); 0.7197 (0.3); 0.0350 (2.4)
1-028: ¹H-NMR(499.9 MHz, d₆-DMSO):
δ = 8.2502 (16.0); 8.0080 (1.2); 7.2221 (0.5); 7.2063 (1.3); 7.2027 (1.4); 7.1899 (3.5); 7.1868 (3.2);
7.1767 (7.8); 7.1620 (5.1); 7.1458 (1.7); 6.9476 (2.0); 6.9442 (2.1); 6.9334 (2.8); 6.9290 (3.0); 6.9209
(1.5); 6.9154 (1.3); 2.5087 (2.8); 2.5051 (3.7); 2.5016 (2.6); 2.0890 (0.9); 2.0788 (1.6); 2.0720 (1.8);
2.0620 (2.9); 2.0519 (1.7); 2.0452 (1.5); 2.0348 (0.7); 1.9900 (0.6); 1.1759 (0.4); 1.0341 (2.4); 1.0255
(5.8); 1.0211 (5.8); 1.0175 (3.2); 1.0127 (3.3); 1.0086 (5.4); 1.0042 (5.4); 0.9960 (2.0); 0.8237 (0.4);
0.8130 (0.5); 0.7937 (2.7); 0.7854 (6.6); 0.7813 (6.5); 0.7753 (6.2); 0.7712 (6.0); 0.7622 (1.8)
1-029: ¹H-NMR(300.2 MHz, d₆-DMSO):
δ = 8.7017 (8.2); 8.6822 (0.4); 8.6150 (16.0); 8.1049 (5.4); 8.1005 (8.6); 8.0962 (5.2); 8.0833 (0.5);
7.7696 (1.4); 7.7437 (4.2); 7.7183 (9.1); 7.6944 (5.6); 7.6687 (1.9); 7.6356 (3.6); 7.6090 (2.1); 7.2299
(7.3); 4.0835 (0.4); 4.0598 (0.9); 4.0362 (0.9); 4.0126 (0.4); 3.5263 (0.4); 3.4997 (0.4); 3.4710 (0.4);
3.4452 (0.4); 3.4323 (0.4); 3.3829 (0.4); 3.3265 (0.4); 2.5831 (0.4); 2.5341 (6.1); 2.5284 (11.2);
2.5224 (14.1); 2.5165 (9.7); 2.1057 (0.5); 2.0088 (3.5); 1.9293 (1.9); 1.3751 (1.0); 1.2838 (0.3);
1.2536 (1.2); 1.2174 (1.1); 1.1937 (2.0); 1.1700 (1.0); 0.0187 (3.2); 0.0077 (0.4); −0.0393 (1.5)
1-030: ¹H-NMR(300.2 MHz, d₆-DMSO):
δ = 8.0139 (9.2); 7.7429 (0.8); 7.7169 (2.4); 7.6915 (2.4); 7.6678 (3.0); 7.6430 (4.7); 7.5644 (2.0);
7.5380 (1.5); 3.0021 (1.8); 2.9768 (5.6); 2.9515 (5.7); 2.9263 (1.9); 2.5341 (2.3); 2.5281 (4.7); 2.5221
(6.5); 2.5161 (4.7); 2.5102 (2.2); 2.0085 (0.5); 1.9290 (0.4); 1.3136 (7.2); 1.2884 (16.0); 1.2631 (6.9);
0.0182 (7.1); −0.0419 (1.3)
1-031: ¹H-NMR(300.2 MHz, d₆-DMSO):
δ = 8.3847 (16.0); 8.3052 (2.0); 8.2779 (4.0); 8.2524 (2.4); 8.1524 (0.6); 7.8268 (5.3); 7.8021 (4.7);
7.6860 (4.6); 7.6582 (4.2); 4.0602 (0.4); 4.0364 (0.4); 2.5341 (3.6); 2.5281 (7.7); 2.5220 (10.6);
2.5159 (7.7); 2.5100 (3.7); 2.0087 (1.6); 1.2175 (0.4); 1.1937 (0.9); 1.1700 (0.4); 0.0295 (0.5); 0.0187
(13.3); 0.0077 (0.5)
1-033: ¹H-NMR(499.9 MHz, CDCl3):
δ = 7.3477 (0.7); 7.3458 (0.7); 7.3312 (1.8); 7.3180 (0.5); 7.3142 (1.3); 7.2703 (0.4); 7.2341 (3.4);
7.2310 (4.1); 7.2277 (1.7); 7.2192 (1.1); 7.2174 (1.2); 7.2155 (1.0); 7.2135 (0.8); 7.1244 (1.0); 7.1211
(1.5); 7.1178 (1.0); 7.1079 (0.9); 7.1060 (1.0); 7.1034 (1.0); 7.1015 (1.0); 4.0266 (0.5); 4.0054 (16.0);
2.4132 (15.4); 2.3714 (0.5); 2.0396 (0.6); 1.7227 (0.4); 1.2683 (0.4); 1.2628 (0.6); 1.2542 (0.6);
0.8930 (0.4); 0.8794 (1.0); 0.8651 (0.5); −0.0002 (0.4)
1-034: ¹H-NMR(300.2 MHz, CDCl3):
δ = 8.9312 (0.5); 8.7218 (5.7); 7.6865 (0.4); 7.6605 (1.5); 7.6368 (4.5); 7.6136 (0.6); 7.5818 (2.3);
7.5362 (1.0); 7.5285 (1.6); 7.5213 (0.9); 7.5058 (1.0); 7.2986 (8.3); 7.1162 (0.3); 4.1844 (0.7); 4.1606
(0.8); 3.8821 (0.4); 2.8702 (16.0); 2.6686 (1.2); 2.1970 (2.5); 2.1014 (3.4); 1.9497 (0.5); 1.6815 (0.4);
1.4679 (0.4); 1.4314 (0.3); 1.4067 (0.5); 1.3816 (0.5); 1.3593 (0.8); 1.3319 (0.6); 1.3261 (1.1); 1.3023
(2.0); 1.2902 (0.4); 1.2784 (1.0); 0.9825 (1.0); 0.9582 (1.8); 0.9340 (0.8); 0.1065 (0.7); 0.0352 (8.0);
0.0243 (0.4)
1-035: ¹H-NMR(300.2 MHz, CDCl3):
δ = 7.7672 (4.6); 7.5697 (1.0); 7.5431 (1.7); 7.5290 (2.2); 7.5215 (1.8); 7.4764 (0.8); 7.4707 (1.1);
7.4641 (0.7); 7.4453 (0.7); 7.2990 (5.2); 5.3887 (0.4); 5.3679 (1.0); 5.3470 (1.3); 5.3261 (1.0); 5.3053
(0.4); 3.1003 (1.0); 3.0749 (3.3); 3.0496 (3.4); 3.0243 (1.2); 1.6181 (9.2); 1.4489 (4.2); 1.4341 (16.0);
1.4236 (8.8); 1.4132 (15.9); 1.3982 (3.9); 0.1066 (1.2); 0.0359 (4.9)
1-037: ¹H-NMR(300.2 MHz, d₆-DMSO):
δ = 7.3284 (1.1); 7.3025 (2.6); 7.2763 (1.6); 6.9713 (1.7); 6.9453 (1.6); 6.9167 (1.2); 6.9137 (1.3);
6.9088 (1.7); 6.9058 (1.5); 6.8794 (3.8); 6.8741 (2.7); 2.5667 (15.0); 2.5339 (2.5); 2.5280 (5.0);
2.5219 (7.0); 2.5158 (5.1); 2.5099 (2.5); 2.3802 (0.5); 2.3081 (14.9); 2.0993 (0.8); 1.9884 (0.7);
1.9772 (0.7); 1.9722 (0.6); 1.9606 (1.4); 1.9440 (0.9); 1.9294 (16.0); 1.9172 (0.7); 1.0060 (0.9);
0.9915 (2.4); 0.9840 (2.7); 0.9783 (1.4); 0.9704 (1.5); 0.9634 (2.6); 0.9560 (2.5); 0.9426 (1.1); 0.7213
(1.1); 0.7075 (2.6); 0.7043 (2.3); 0.7005 (2.9); 0.6909 (2.6); 0.6839 (2.9); 0.6689 (0.9); 0.0689 (0.8);
0.0203 (9.0); 0.0094 (0.4)
1-038: ¹H-NMR(300.2 MHz, d₆-DMSO):
δ = 7.7702 (0.8); 7.7434 (2.8); 7.7162 (4.7); 7.7082 (4.7); 7.6845 (6.1); 7.6111 (2.9); 7.5856 (1.9);
4.4847 (2.5); 4.4615 (8.0); 4.4383 (8.2); 4.4152 (2.6); 2.5402 (5.1); 2.5347 (6.6); 2.5291 (4.9); 2.1077
(0.8); 1.4582 (7.9); 1.4350 (16.0); 1.4118 (7.7); 0.0305 (5.0)
1-039: ¹H-NMR(300.2 MHz, CDCl3):
δ = 8.0165 (5.2); 7.5853 (1.0); 7.5593 (2.0); 7.5527 (1.6); 7.5470 (1.9); 7.5370 (1.8); 7.4918 (0.7);
7.4850 (1.1); 7.4782 (0.6); 7.4654 (0.4); 7.4598 (0.6); 7.2985 (4.6); 7.1094 (1.0); 7.0725 (1.2); 7.0501
(1.2); 7.0133 (1.2); 6.2880 (2.3); 6.2288 (2.0); 5.7406 (2.3); 5.7037 (2.1); 5.4053 (0.4); 5.3845 (1.0);
5.3636 (1.4); 5.3427 (1.0); 5.3219 (0.4); 1.6133 (1.8); 1.4481 (16.0); 1.4272 (15.8); 0.0363 (4.3)
1-040: ¹H-NMR(400.1 MHz, d₆-DMSO):
δ = 7.8912 (5.7); 7.3097 (1.3); 7.2902 (2.8); 7.2706 (1.7); 6.9569 (2.0); 6.9376 (1.9); 6.9046 (1.9);
6.8752 (3.4); 2.6079 (16.0); 2.5101 (2.7); 1.9793 (0.3); 1.9665 (0.7); 1.9580 (0.9); 1.9458 (1.4);
1.9335 (1.0); 1.9250 (0.9); 1.9123 (0.4); 0.9823 (0.8); 0.9712 (2.4); 0.9660 (2.8); 0.9504 (2.7); 0.9453
(2.8); 0.9351 (1.2); 0.7049 (1.0); 0.6935 (3.0); 0.6899 (3.2); 0.6818 (3.0); 0.6774 (3.3); 0.6659 (1.0)
1-041: ¹H-NMR(300.2 MHz, CDCl3):
δ = 7.8520 (4.3); 7.5819 (0.6); 7.5583 (1.4); 7.5372 (1.4); 7.5170 (0.7); 7.3531 (0.7); 7.3263 (1.1);
7.2986 (2.2); 4.0423 (16.0); 2.7528 (14.2); 1.2898 (0.5); 0.0335 (1.6)
1-042: ¹H-NMR(300.2 MHz, CDCl3):
δ = 7.3686 (0.8); 7.3420 (2.0); 7.3153 (1.4); 7.3147 (1.4); 7.2987 (1.1); 7.2644 (0.9); 7.2579 (1.9);
7.2513 (1.4); 7.2398 (1.1); 7.2362 (1.4); 7.2337 (0.9); 7.2298 (0.8); 7.2132 (0.7); 7.2097 (0.7); 7.2068
(0.6); 7.2033 (0.5); 7.1579 (1.0); 7.1542 (0.9); 7.1504 (0.9); 7.1469 (0.8); 7.1308 (0.7); 7.1273 (0.7);
7.1231 (0.7); 7.1197 (0.6); 4.0279 (0.5); 4.0261 (0.5); 4.0170 (16.0); 4.0079 (0.9); 2.6590 (12.4);
2.6426 (0.5); 2.3363 (12.3); 2.3225 (0.6); 1.7379 (2.0); 1.2966 (0.4); 1.2893 (0.4); 0.9120 (0.4);
0.0307 (0.8)
1-043: ¹H-NMR(400.1 MHz, d₆-DMSO):
δ = 7.9195 (16.0); 7.7070 (2.1); 7.6877 (5.3); 7.6679 (4.5); 7.6347 (6.0); 7.6031 (7.9); 7.5251 (4.2);
7.5050 (3.6); 4.0031 (0.3); 3.3797 (1.1); 3.3371 (1.2); 2.5098 (7.0); 2.3668 (0.8); 2.3544 (1.8); 2.3460
(2.2); 2.3338 (3.6); 2.3219 (2.4); 2.3137 (2.1); 2.3014 (1.1); 1.1157 (1.5); 1.1036 (4.1); 1.0975 (7.0);
1.0901 (4.4); 1.0829 (4.6); 1.0773 (7.0); 1.0697 (3.7); 1.0559 (1.5); 1.0430 (3.3); 1.0352 (7.4); 1.0301
(7.4); 1.0232 (8.0); 1.0174 (6.1); 1.0055 (2.2)
1-044: ¹H-NMR(300.2 MHz, d₆-DMSO):
δ = 8.2409 (16.0); 8.1115 (0.6); 7.9405 (1.1); 7.8747 (1.8); 7.8503 (3.7); 7.8227 (2.3); 7.8127 (2.0);
7.7868 (3.6); 7.7656 (2.3); 7.5853 (2.5); 7.5587 (4.1); 7.5321 (1.8); 4.1145 (0.5); 4.0839 (0.4); 4.0726
(1.0); 4.0489 (1.0); 3.5064 (0.4); 3.3515 (0.6); 3.3099 (0.5); 3.0723 (1.7); 3.0521 (0.7); 3.0411 (0.5);
3.0096 (0.3); 2.9228 (1.8); 2.8928 (0.7); 2.8579 (0.4); 2.7637 (1.5); 2.5463 (9.6); 2.5404 (20.1);
2.5343 (27.5); 2.5283 (19.6); 2.5224 (9.0); 2.0211 (3.9); 1.3872 (0.8); 1.2914 (0.5); 1.2660 (1.1);
1.2300 (1.3); 1.2062 (2.6); 1.2012 (1.1); 1.1825 (1.2); 0.1641 (0.4); 0.1162 (0.4); 0.0419 (0.5); 0.0310
(14.4); 0.0201 (0.6)
1-045: ¹H-NMR(300.2 MHz, CDCl3):
δ = 7.8837 (5.5); 7.4257 (2.7); 7.4229 (2.9); 7.4137 (1.5); 7.4095 (2.0); 7.4066 (2.2); 7.4050 (2.1);
7.3802 (1.6); 7.3754 (1.5); 7.3722 (1.4); 7.2987 (3.2); 7.2777 (0.9); 7.2693 (0.8); 7.2661 (0.7); 7.2581
(0.8); 7.2518 (0.6); 7.2466 (0.6); 7.2385 (0.5); 5.3876 (0.4); 5.3668 (1.0); 5.3459 (1.4); 5.3250 (1.0);
5.3042 (0.4); 3.1337 (4.6); 1.6009 (4.7); 1.4411 (16.0); 1.4203 (15.8); 0.0368 (3.7)
1-046: ¹H-NMR(300.2 MHz, CDCl3):
δ = 7.6042 (0.4); 7.5790 (1.6); 7.5575 (4.1); 7.5025 (2.2); 7.4823 (0.3); 7.4642 (1.0); 7.4556 (1.4);
7.4482 (1.0); 7.4341 (0.9); 7.2967 (3.9); 4.2444 (0.9); 4.1624 (15.6); 4.0647 (16.0); 1.5933 (3.9);
1.2906 (1.1); 0.0346 (3.8)
1-047: ¹H-NMR(499.9 MHz, CDCl3):
δ = 7.9753 (5.2); 7.6683 (0.6); 7.5512 (0.8); 7.5390 (1.8); 7.5259 (2.2); 7.5122 (1.1); 7.3323 (1.0);
7.3162 (1.8); 7.3001 (0.8); 7.2636 (1.5); 7.0994 (0.4); 4.0289 (16.0); 3.1503 (0.4); 2.9572 (1.4);
2.9112 (0.4); 2.8836 (1.2); −0.0002 (1.2)
1-048: ¹H-NMR(400.1 MHz, d₆-DMSO):
δ = 8.2321 (16.0); 7.5551 (8.5); 7.5506 (6.0); 7.5092 (3.4); 7.4888 (6.3); 7.4574 (4.8); 7.4373 (7.6);
7.4173 (3.5); 7.3037 (4.4); 7.3012 (4.4); 7.2836 (3.6); 7.2812 (3.6); 2.5097 (2.3)
1-049: ¹H-NMR(499.9 MHz, CDCl3):
δ = 7.5658 (1.2); 7.5527 (3.4); 7.5398 (0.3); 7.4911 (1.5); 7.4397 (0.6); 7.4346 (1.1); 7.4303 (0.8);
7.4280 (0.5); 7.4258 (0.5); 7.4218 (0.7); 7.4171 (0.4); 7.2620 (0.9); 4.1764 (0.4); 4.0726 (1.0); 4.0590
(16.0); 3.9974 (0.4); −0.0002 (0.8)
1-050: ¹H-NMR(300.2 MHz, d₆-DMSO):
δ = 8.6812 (1.0); 8.6207 (2.3); 8.1045 (0.6); 8.1000 (1.0); 8.0954 (0.6); 7.7447 (0.5); 7.7179 (1.0);
7.6933 (0.6); 7.6318 (0.4); 7.2260 (0.8); 5.2581 (0.4); 5.2373 (0.5); 5.2165 (0.4); 3.3506 (16.0);
2.5342 (1.0); 2.5283 (2.2); 2.5222 (3.0); 2.5162 (2.1); 2.5102 (1.0); 1.3599 (5.9); 1.3391 (5.8); 0.0194 (0.8)
1-051: ¹H-NMR(300.2 MHz, d₆-DMSO):
δ = 8.3714 (6.2); 8.3653 (6.3); 8.3270 (6.0); 8.3186 (6.1); 8.2572 (16.0); 7.4202 (3.8); 7.4128 (6.0);
7.4055 (3.8); 5.7785 (1.2); 3.4711 (0.4); 3.4031 (0.5); 3.3840 (0.5); 3.2446 (0.4); 2.5341 (4.0); 2.5282
(8.4); 2.5222 (11.5); 2.5162 (8.4); 2.5103 (4.1); 2.0860 (0.6); 2.0692 (1.3); 2.0578 (1.5); 2.0412 (2.7);
2.0246 (1.6); 2.0132 (1.6); 1.9965 (0.8); 1.1944 (0.4); 1.0786 (1.6); 1.0637 (4.4); 1.0562 (5.0); 1.0424
(2.7); 1.0356 (4.6); 1.0281 (4.5); 1.0146 (2.0); 0.8207 (2.0); 0.8066 (5.2); 0.7998 (5.3); 0.7903 (4.9);
0.7833 (5.6); 0.7678 (1.6); 0.0306 (0.4); 0.0197 (10.2); 0.0086 (0.5)
1-052: ¹H-NMR(499.9 MHz, CDCl3):
δ = 7.5717 (0.3); 7.5706 (0.3); 7.5562 (1.2); 7.5436 (3.3); 7.4786 (1.5); 7.4294 (0.6); 7.4239 (1.1);
7.4197 (0.8); 7.4157 (0.5); 7.4107 (0.7); 7.4065 (0.4); 7.2606 (2.2); 4.1428 (0.3); 4.0748 (1.1); 4.0582
(16.0); 3.9978 (0.3); 1.5556 (2.7); −0.0002 (2.2)
1-053: ¹H-NMR(300.2 MHz, d₆-DMSO):
δ = 8.9232 (0.6); 8.8705 (5.1); 8.7368 (2.9); 8.7204 (3.0); 8.4955 (7.6); 8.2803 (0.8); 7.7880 (2.9);
7.7717 (2.8); 7.5349 (0.5); 7.5222 (0.6); 7.5125 (0.7); 7.5007 (1.1); 7.4928 (0.7); 7.4881 (0.7); 7.4767
(1.1); 7.4667 (0.8); 7.4573 (0.6); 7.4433 (0.6); 7.4263 (0.5); 7.4155 (0.5); 7.3993 (3.2); 7.3863 (3.8);
7.3754 (2.0); 7.3637 (1.0); 7.3344 (0.4); 4.0845 (0.6); 4.0607 (1.8); 4.0370 (1.9); 4.0133 (0.7); 3.3635
(0.5); 3.1890 (0.3); 2.5342 (2.7); 2.5284 (5.7); 2.5224 (7.9); 2.5164 (5.9); 2.5106 (3.0); 2.0085 (8.3);
1.9293 (3.1); 1.2178 (2.2); 1.1941 (4.2); 1.1704 (2.1); 1.0893 (16.0); 0.0186 (4.4)
1-054: ¹H-NMR(300.2 MHz, d₆-DMSO):
δ = 9.0517 (0.4); 7.7345 (1.3); 7.7085 (3.8); 7.6823 (4.2); 7.6629 (4.6); 7.6369 (2.0); 7.5787 (4.9);
7.5312 (3.5); 7.5052 (2.6); 7.4437 (0.6); 7.4262 (0.6); 7.4087 (0.8); 7.2862 (0.4); 7.1165 (0.4); 4.0613
(0.7); 4.0376 (0.7); 3.3468 (0.5); 3.1893 (0.3); 2.9676 (2.1); 2.9428 (6.4); 2.9179 (6.5); 2.8932 (2.2);
2.5344 (4.8); 2.5285 (9.6); 2.5224 (12.8); 2.5164 (9.0); 2.5107 (4.0); 2.3794 (1.5); 2.3375 (25.8);
2.0950 (0.5); 2.0091 (2.8); 1.2909 (7.8); 1.2661 (16.0); 1.2413 (7.2); 1.2184 (0.8); 1.1947 (1.5);
1.1709 (0.7); 0.0304 (0.7); 0.0196 (13.8); 0.0086 (0.4); −0.0406 (1.0)
1-055: ¹H-NMR(300.2 MHz, CDCl3):
δ = 7.5959 (0.6); 7.5745 (1.0); 7.5523 (0.6); 7.5012 (0.5); 7.4763 (1.2); 7.4523 (0.8); 7.3728 (1.0);
7.3476 (1.2); 7.3198 (0.5); 7.2988 (7.5); 7.1046 (0.9); 6.9353 (0.6); 6.9223 (1.9); 6.7399 (0.9); 4.1162
(3.5); 4.1049 (16.0); 4.0922 (1.0); 4.0670 (0.6); 4.0386 (0.3); 1.6176 (0.4); 1.5935 (5.8); 1.3870 (0.4);
1.2929 (0.4); 0.1077 (2.1); 0.0374 (6.9); 0.0265 (0.3)
1-056: ¹H-NMR(300.2 MHz, CDCl3):
δ = 7.9045 (4.4); 7.4588 (0.3); 7.4443 (0.4); 7.4349 (2.3); 7.4061 (2.6); 7.3729 (0.4); 7.3508 (1.9);
7.3245 (4.0); 7.2984 (19.6); 7.0244 (4.2); 7.0162 (3.3); 7.0044 (3.0); 6.9980 (3.2); 6.9899 (2.2);
6.9865 (2.2); 6.9762 (1.3); 6.9373 (2.6); 6.9311 (3.2); 6.9243 (1.8); 6.8304 (1.8); 6.8210 (1.6); 6.8080
(0.4); 4.5949 (0.7); 4.5870 (2.4); 4.5817 (0.8); 4.5632 (7.1); 4.5394 (7.2); 4.5313 (1.5); 4.5157 (2.6);
4.5074 (3.3); 4.4836 (3.2); 4.4598 (1.1); 2.2702 (0.4); 2.2594 (0.4); 2.2419 (0.8); 2.2255 (0.4); 2.2138
(0.4); 1.9860 (0.4); 1.9691 (0.9); 1.9578 (1.0); 1.9412 (1.8); 1.9245 (1.1); 1.9132 (1.0); 1.8962 (0.5);
1.6190 (0.3); 1.5864 (14.6); 1.5204 (0.6); 1.4963 (1.6); 1.4869 (8.1); 1.4787 (4.3); 1.4721 (2.3);
1.4631 (16.0); 1.4550 (7.8); 1.4485 (1.6); 1.4394 (7.8); 1.4312 (3.7); 1.3021 (1.3); 1.2969 (1.0);
1.2736 (0.4); 1.0913 (0.7); 1.0756 (1.7); 1.0697 (1.7); 1.0634 (1.1); 1.0544 (1.3); 1.0460 (2.6); 1.0416
(2.0); 1.0301 (3.3); 1.0234 (3.6); 1.0083 (2.0); 1.0017 (3.3); 0.9951 (2.8); 0.9804 (1.5); 0.7653 (1.6);
0.7499 (4.0); 0.7436 (3.8); 0.7334 (3.7); 0.7272 (5.4); 0.7112 (2.4); 0.7039 (2.1); 0.6872 (0.6); 0.1081
(0.4); 0.0488 (0.8); 0.0381 (17.7); 0.0272 (0.7)
1-057: ¹H-NMR(300.2 MHz, CDCl3):
δ = 8.4033 (16.0); 7.6856 (0.8); 7.6598 (4.2); 7.6407 (10.8); 7.6374 (10.2); 7.5838 (5.3); 7.5494 (0.9);
7.5427 (0.8); 7.5336 (2.2); 7.5228 (3.1); 7.5156 (2.8); 7.5028 (2.2); 7.4954 (1.5); 7.3906 (0.4); 7.3742
(0.4); 7.3606 (0.3); 7.2986 (62.6); 6.9476 (0.3); 5.0308 (0.4); 4.0812 (0.5); 3.8943 (0.6); 3.8725 (0.7);
3.7159 (1.1); 3.6788 (1.7); 3.6611 (1.0); 3.5391 (0.7); 3.4838 (0.4); 3.4479 (0.3); 3.2596 (0.4); 3.2174
(1.2); 3.1656 (0.6); 3.0881 (0.6); 3.0787 (0.6); 3.0061 (0.4); 2.9309 (1.1); 2.1975 (0.9); 2.0977 (0.7);
1.4829 (0.4); 1.4699 (2.7); 1.4486 (0.3); 1.4286 (0.3); 1.3620 (0.4); 1.2922 (3.3); 1.2760 (0.8); 1.2506
(0.5); 0.9162 (0.4); 0.1071 (14.1); 0.0947 (0.6); 0.0479 (2.0); 0.0372 (44.4); 0.0263 (1.8)
1-058: ¹H-NMR(300.2 MHz, CDCl3):
δ = 7.8995 (5.5); 7.5887 (0.6); 7.2987 (3.4); 7.1384 (0.3); 7.1201 (1.3); 7.1163 (1.4); 7.1109 (2.2);
7.0931 (3.4); 7.0661 (0.3); 6.8539 (0.6); 6.8451 (0.7); 6.8314 (1.0); 6.8215 (0.8); 6.8166 (1.1); 6.8003
(0.4); 5.4035 (0.4); 5.3827 (1.0); 5.3618 (1.4); 5.3409 (1.0); 5.3201 (0.4); 2.1478 (0.4); 2.1369 (0.5);
2.1304 (0.4); 2.1196 (0.9); 2.1087 (0.4); 2.1021 (0.6); 2.0914 (0.5); 1.6022 (2.8); 1.4751 (1.8); 1.4579
(16.0); 1.4371 (15.5); 1.0643 (0.7); 1.0492 (1.6); 1.0423 (1.7); 1.0362 (0.9); 1.0329 (0.7); 1.0275
(1.2); 1.0206 (1.8); 1.0138 (1.6); 0.9993 (0.9); 0.8139 (0.8); 0.7990 (1.9); 0.7929 (1.8); 0.7818 (1.8);
0.7764 (1.9); 0.7645 (0.6); 0.7597 (0.9); 0.7476 (0.4); 0.7418 (0.4); 0.0381 (3.4)
1-059: ¹H-NMR(300.2 MHz, CDCl3):
δ = 8.2245 (5.3); 7.6379 (1.1); 7.6167 (3.3); 7.5953 (0.4); 7.5685 (1.5); 7.5201 (0.7); 7.5109 (1.1);
7.5036 (0.7); 7.4971 (0.4); 7.4889 (0.6); 7.4819 (0.4); 7.2985 (6.2); 5.4415 (0.4); 5.4205 (1.0); 5.3996
(1.4); 5.3788 (1.0); 5.3580 (0.4); 4.0917 (0.4); 2.9951 (0.5); 2.9228 (0.4); 1.5930 (1.9); 1.4811 (16.0);
1.4602 (15.9); 0.1074 (0.9); 0.0368 (5.0)
1-060: ¹H-NMR(499.9 MHz, CDCl3):
δ = 7.5495 (1.9); 7.5340 (7.4); 7.5182 (13.7); 7.4997 (2.3); 7.4695 (10.2); 7.4209 (5.8); 7.4062 (4.7);
7.3878 (0.6); 7.2606 (11.5); 5.2971 (0.7); 4.5407 (0.6); 4.5266 (1.8); 4.5125 (2.4); 4.5021 (5.8);
4.4879 (16.0); 4.4736 (15.8); 4.4594 (5.2); 4.3889 (5.0); 4.3749 (15.5); 4.3610 (15.6); 4.3471 (5.2);
1.5548 (14.0); 1.5088 (16.0); 1.4948 (31.9); 1.4808 (15.7); 1.4563 (2.0); 1.4497 (2.1); 1.4423 (4.0);
1.4354 (3.9); 1.4214 (17.8); 1.4071 (32.0); 1.3928 (15.8); 1.2776 (0.4); 1.2571 (1.2); −0.0002 (11.5)
1-061: ¹H-NMR(300.2 MHz, CDCl3):
δ = 7.8527 (4.8); 7.8448 (0.7); 7.4713 (1.5); 7.3465 (0.9); 7.3329 (0.6); 7.3203 (1.7); 7.3065 (0.4);
7.2983 (1.8); 7.2940 (1.3); 7.0217 (1.2); 7.0137 (1.9); 7.0082 (1.4); 6.9977 (1.0); 6.9945 (1.0); 6.9866
(1.6); 6.9832 (1.3); 6.9467 (1.3); 6.9404 (1.7); 6.9331 (1.1); 6.9253 (0.5); 5.3803 (0.4); 5.3706 (0.3);
5.3595 (1.0); 5.3497 (0.4); 5.3387 (1.3); 5.3309 (0.7); 5.3178 (1.0); 5.2970 (0.4); 1.9690 (0.5); 1.9576
(0.5); 1.9410 (0.9); 1.9242 (0.5); 1.9131 (0.5); 1.6409 (2.4); 1.4629 (2.6); 1.4591 (4.6); 1.4361 (16.0);
1.4151 (14.5); 1.4033 (0.6); 1.3822 (0.4); 1.0347 (0.9); 1.0296 (0.6); 1.0194 (1.5); 1.0125 (1.7);
1.0096 (1.3); 0.9978 (1.0); 0.9910 (1.6); 0.9847 (1.4); 0.9697 (0.8); 0.7664 (0.9); 0.7513 (2.3); 0.7453
(2.0); 0.7348 (1.8); 0.7290 (2.4); 0.7126 (0.7); 0.0368 (1.6)
1-062: ¹H-NMR(300.2 MHz, d₆-DMSO):
δ = 8.3065 (16.0); 8.1039 (1.2); 7.7140 (1.2); 7.6870 (2.5); 7.6596 (1.8); 7.6421 (1.3); 7.6195 (2.5);
7.5986 (1.6); 7.4977 (2.4); 7.4826 (3.1); 7.4711 (3.4); 7.4442 (1.3); 7.3027 (5.4); 7.1228 (2.7); 4.0602
(1.0); 4.0365 (1.0); 4.0127 (0.4); 3.4910 (0.3); 2.5341 (3.0); 2.5282 (6.4); 2.5221 (8.9); 2.5160 (6.6);
2.5101 (3.2); 2.0087 (4.4); 1.9291 (1.1); 1.2176 (1.2); 1.1939 (2.4); 1.1701 (1.2); 1.1561 (0.5); 0.0186
(9.5); 0.0076 (0.5); −0.0425 (2.0)
1-063: ¹H-NMR(300.2 MHz, d₆-DMSO):
δ = 8.7017 (1.3); 8.6952 (1.5); 8.6861 (6.0); 8.6850 (5.6); 8.6797 (6.3); 8.6674 (1.4); 8.6596 (1.4);
8.6268 (5.9); 8.6189 (6.2); 8.3059 (16.0); 8.2818 (0.9); 8.2749 (1.4); 8.2674 (0.8); 8.2297 (4.5);
8.2230 (6.4); 8.2154 (4.1); 8.1457 (0.4); 8.0647 (0.3); 8.0472 (3.3); 5.7778 (0.4); 4.0597 (0.5); 4.0360
(0.4); 3.1873 (0.4); 2.5611 (14.4); 2.5339 (3.5); 2.5279 (7.4); 2.5218 (10.0); 2.5158 (7.2); 2.5099
(3.3); 2.0085 (1.8); 1.9286 (1.0); 1.2173 (0.5); 1.1936 (1.0); 1.1698 (0.5); 0.0294 (0.5); 0.0186 (13.5);
0.0093 (0.4); 0.0076 (0.5)
1-064: ¹H-NMR(300.2 MHz, CDCl3):
δ = 7.6140 (0.6); 7.5922 (1.2); 7.5698 (1.5); 7.5467 (0.7); 7.3813 (0.7); 7.3551 (1.0); 7.3275 (0.4);
7.2990 (6.7); 4.1179 (2.2); 4.1089 (16.0); 1.6002 (1.0); 1.2938 (0.6); 1.2737 (0.9); 1.2678 (0.4);
0.9187 (0.4); 0.0367 (6.7)
1-065: ¹H-NMR(300.2 MHz, CDCl3):
δ = 7.2986 (6.2); 7.1237 (0.4); 7.1045 (1.4); 7.0965 (2.2); 7.0911 (2.7); 7.0769 (1.8); 7.0728 (2.5);
7.0454 (0.5); 6.8423 (0.3); 6.8363 (0.7); 6.8284 (0.8); 6.8208 (0.5); 6.8141 (1.1); 6.8033 (0.8); 6.7976
(0.8); 6.7828 (0.5); 5.8161 (0.4); 5.4585 (0.4); 5.4377 (1.0); 5.4168 (1.4); 5.3959 (1.1); 5.3751 (0.4);
2.6527 (8.2); 2.4601 (15.6); 2.4508 (2.3); 2.1444 (0.5); 2.1331 (0.6); 2.1162 (1.0); 2.0996 (0.7);
2.0878 (0.6); 2.0711 (0.3); 1.6184 (0.6); 1.4808 (1.7); 1.4701 (0.6); 1.4552 (16.0); 1.4343 (15.6);
1.4130 (0.5); 1.3921 (0.4); 1.2935 (0.4); 1.0594 (0.8); 1.0441 (1.9); 1.0373 (2.0); 1.0312 (1.4); 1.0226
(1.5); 1.0155 (2.0); 1.0091 (1.8); 0.9945 (1.1); 0.8051 (1.0); 0.7901 (2.2); 0.7840 (2.1); 0.7732 (2.0);
0.7670 (2.3); 0.7574 (0.7); 0.7509 (0.8); 0.7410 (0.5); 0.1079 (1.1); 0.0374 (5.2)
1-066: ¹H-NMR(499.9 MHz, CDCl3):
δ = 8.1443 (5.2); 7.5649 (0.5); 7.5494 (1.7); 7.5338 (2.0); 7.5254 (2.4); 7.5099 (0.9); 7.4936 (2.5);
7.4298 (1.5); 7.4146 (1.2); 7.2672 (0.5); 5.3302 (0.5); 5.3177 (1.2); 5.3052 (1.6); 5.2927 (1.2); 5.2802
(0.5); 1.6345 (0.4); 1.4002 (15.4); 1.3876 (16.0); −0.0002 (0.5)
1-067: ¹H-NMR(499.9 MHz, d₆-DMSO):
δ = 8.0179 (6.6); 7.7953 (0.7); 7.7804 (1.4); 7.7656 (0.8); 7.7208 (0.7); 7.7069 (1.2); 7.6936 (0.8);
7.5189 (1.0); 7.5027 (1.6); 7.4865 (0.7); 2.6214 (16.0); 2.5058 (0.4); 1.3515 (0.9)
1-068: ¹H-NMR(300.2 MHz, CDCl3):
δ = 7.5329 (0.7); 7.5066 (2.3); 7.4812 (1.9); 7.4459 (2.0); 7.4053 (2.3); 7.3599 (1.4); 7.3323 (1.0);
7.3067 (6.2); 5.5646 (0.3); 5.3280 (0.5); 5.3072 (1.1); 5.2864 (1.5); 5.2656 (1.1); 5.2448 (0.5); 2.6875
(0.5); 2.6772 (0.8); 2.6664 (1.0); 2.6556 (0.8); 2.6452 (0.6); 1.4524 (1.3); 1.4316 (1.4); 1.3492 (16.0);
1.3284 (16.0); 1.2987 (0.9); 0.9515 (0.6); 0.9288 (2.4); 0.9120 (2.5); 0.8904 (0.8); 0.6958 (0.8);
0.6800 (2.2); 0.6733 (2.6); 0.6461 (0.6); 0.0441 (6.0)
1-069: ¹H-NMR(300.2 MHz, CDCl3):
δ = 7.5879 (2.7); 7.5816 (2.7); 7.5680 (4.8); 7.5440 (1.0); 7.5233 (2.8); 7.4797 (1.5); 7.4738 (1.8);
7.4668 (1.3); 7.4568 (1.2); 7.4512 (1.3); 7.3127 (0.4); 7.3003 (1.4); 7.2951 (2.7); 6.8372 (0.6); 6.8321
(1.1); 6.7932 (1.5); 6.7782 (0.7); 6.7731 (1.3); 6.7491 (0.5); 6.7393 (0.8); 6.7342 (1.5); 6.3408 (0.5);
6.2819 (0.4); 5.9556 (1.8); 5.9503 (2.7); 5.9177 (0.9); 5.8952 (3.8); 5.8562 (2.3); 4.0582 (2.1); 4.0531
(3.5); 4.0245 (2.2); 4.0128 (8.4); 4.0078 (16.0); 1.6205 (0.5); 1.6087 (2.0); 1.6040 (3.6); 0.0493 (0.4);
0.0377 (1.3); 0.0326 (2.6)
1-070: ¹H-NMR(400.2 MHz, d₆-DMSO):
δ = 7.7089 (0.7); 7.6892 (2.0); 7.6694 (1.7); 7.6395 (2.0); 7.6200 (1.1); 7.5614 (2.6); 7.5153 (1.4);
7.4954 (1.1); 2.5592 (16.4); 2.5156 (2.0); 2.5112 (4.2); 2.5069 (5.7); 2.5024 (4.1); 2.4983 (2.0);
2.3154 (0.5); 2.3022 (16.0); 0.0008 (4.3)
1-071: ¹H-NMR(300.2 MHz, CDCl3):
δ = 8.0795 (5.2); 8.0524 (0.7); 8.0253 (1.4); 7.9997 (0.8); 7.5587 (1.8); 7.5339 (1.6); 7.4377 (1.6);
7.4100 (1.4); 7.2985 (4.0); 5.3364 (0.5); 4.0608 (0.7); 3.8576 (16.0); 3.1416 (0.5); 1.6031 (4.4);
0.1054 (0.8); 0.0349 (3.5)
1-072: ¹H-NMR(300.2 MHz, CDCl3):
δ = 8.2043 (5.1); 7.5859 (1.0); 7.5595 (2.0); 7.5517 (1.6); 7.5471 (1.5); 7.5332 (2.0); 7.4915 (0.8);
7.4854 (1.1); 7.4788 (0.6); 7.4604 (0.6); 7.2986 (5.3); 5.6409 (2.3); 5.6325 (2.4); 5.4040 (0.4); 5.3831
(1.0); 5.3623 (1.4); 5.3414 (1.0); 5.3205 (0.4); 4.5051 (2.0); 4.4967 (2.0); 4.0863 (0.9); 4.0630 (3.0);
4.0397 (3.1); 4.0164 (1.0); 1.5943 (5.2); 1.5232 (3.4); 1.5000 (7.1); 1.4767 (3.4); 1.4479 (16.0);
1.4270 (15.8); 1.4090 (0.3); 1.3594 (0.3); 0.9838 (0.4); 0.9596 (0.8); 0.9353 (0.3); 0.1073 (0.3);
0.0366 (5.2)
1-073: ¹H-NMR(300.2 MHz, CDCl3):
δ = 7.2988 (4.3); 7.1128 (1.7); 7.1047 (2.2); 7.1007 (1.8); 7.0872 (3.4); 6.8630 (0.6); 6.8544 (0.6);
6.8408 (1.0); 6.8275 (0.7); 6.8096 (0.4); 5.4799 (0.4); 5.4591 (1.0); 5.4382 (1.3); 5.4173 (1.0); 5.3964
(0.4); 2.1481 (0.4); 2.1370 (0.5); 2.1198 (0.8); 2.1026 (0.5); 2.0916 (0.4); 1.6711 (0.8); 1.6615 (0.8);
1.4937 (1.8); 1.4714 (16.0); 1.4505 (14.9); 1.0727 (0.6); 1.0574 (1.7); 1.0507 (1.7); 1.0447 (0.9);
1.0358 (1.0); 1.0288 (1.8); 1.0222 (1.5); 1.0076 (0.7); 0.8119 (0.8); 0.7969 (1.9); 0.7906 (1.9); 0.7799
(1.7); 0.7741 (1.9); 0.7577 (0.6); 0.1078 (0.4); 0.0371 (4.0)
1-074: ¹H-NMR(300.2 MHz, d₆-DMSO):
δ = 8.8704 (1.4); 8.7420 (0.8); 8.7256 (0.9); 8.5221 (1.8); 7.7842 (0.8); 7.7678 (0.8); 7.5120 (0.3);
7.5003 (0.5); 7.4760 (0.4); 7.4015 (0.9); 7.3882 (1.1); 7.3775 (0.7); 7.3634 (0.4); 5.2782 (0.4); 5.2574
(0.5); 5.2366 (0.4); 3.5844 (11.6); 3.3825 (10.1); 2.5285 (0.7); 2.5227 (1.0); 2.5168 (0.7); 2.0055
(0.6); 1.3829 (5.1); 1.3621 (5.1); 1.3484 (0.8); 1.1907 (0.4); 1.1746 (1.4); 1.0877 (16.0); 0.8961 (1.1);
0.0127 (0.4)
1-075: ¹H-NMR(300.2 MHz, CDCl3):
δ = 8.5413 (5.4); 7.6421 (1.0); 7.6171 (2.8); 7.6120 (1.5); 7.5933 (0.4); 7.5691 (1.4); 7.5270 (0.6);
7.5198 (1.1); 7.5126 (0.6); 7.5054 (0.4); 7.5027 (0.4); 7.4969 (0.6); 7.4894 (0.3); 7.2986 (3.4); 5.4233
(0.4); 5.4024 (1.0); 5.3815 (1.3); 5.3606 (1.0); 5.3398 (0.4); 2.8540 (16.0); 2.0810 (0.9); 1.6089 (0.5);
1.4674 (15.9); 1.4465 (15.4); 1.4330 (0.5); 1.4068 (0.4); 1.3808 (0.3); 1.3581 (0.6); 1.3309 (0.4);
1.3048 (0.3); 1.2945 (0.7); 0.9818 (0.7); 0.9576 (1.4); 0.9333 (0.6); 0.0342 (3.1)
1-076: ¹H-NMR(300.2 MHz, CDCl3):
δ = 8.3788 (3.8); 8.3722 (4.6); 8.3691 (4.7); 8.3603 (4.0); 8.1750 (0.6); 7.9458 (10.8); 7.6031 (0.9);
7.2985 (17.2); 7.2701 (0.3); 7.2603 (2.2); 7.2527 (3.3); 7.2456 (2.0); 4.5467 (2.3); 4.5362 (0.8);
4.5229 (7.4); 4.5124 (0.9); 4.4991 (7.5); 4.4887 (0.4); 4.4754 (2.5); 2.0339 (0.4); 2.0171 (0.9); 2.0060
(0.9); 1.9891 (1.8); 1.9723 (1.0); 1.9610 (1.0); 1.9440 (0.5); 1.5607 (0.4); 1.5079 (1.0); 1.4892 (7.9);
1.4841 (2.1); 1.4654 (16.0); 1.4417 (7.6); 1.1307 (1.2); 1.1149 (2.8); 1.1085 (3.1); 1.0927 (1.9);
1.0863 (3.0); 1.0805 (2.6); 1.0648 (1.4); 0.8200 (1.4); 0.8039 (3.9); 0.7989 (3.1); 0.7874 (3.0); 0.7820
(3.9); 0.7653 (1.1); 0.1053 (3.9); 0.0463 (0.6); 0.0355 (18.2); 0.0246 (0.7)
1-077: ¹H-NMR(300.2 MHz, d₆-DMSO):
δ = 7.6152 (2.2); 7.5083 (0.4); 7.4466 (2.6); 7.2777 (2.1); 7.1794 (1.4); 7.1521 (4.7); 7.1336 (5.7);
7.1190 (2.6); 7.0996 (0.7); 6.9334 (1.5); 6.9177 (2.0); 6.9113 (1.8); 6.9031 (2.2); 6.8872 (1.4); 6.8798
(1.0); 6.5450 (0.4); 3.5192 (0.8); 3.3841 (16.0); 2.5659 (2.3); 2.5519 (24.4); 2.5343 (11.2); 2.5284
(22.7); 2.5224 (31.2); 2.5163 (25.9); 2.3835 (0.5); 2.3446 (3.6); 2.3112 (24.3); 2.2623 (0.3); 2.1990
(0.7); 2.1033 (1.8); 2.0950 (2.1); 2.0887 (1.2); 2.0781 (1.2); 2.0605 (2.0); 2.0434 (1.3); 2.0330 (1.1);
2.0154 (0.6); 2.0058 (0.8); 1.9291 (1.3); 1.3718 (1.0); 1.3550 (1.7); 1.3341 (1.7); 1.2897 (0.4); 1.2524
(0.7); 1.1846 (1.9); 1.0513 (1.4); 1.0365 (4.0); 1.0292 (4.3); 1.0157 (2.7); 1.0084 (4.1); 1.0012 (4.0);
0.9880 (1.7); 0.9641 (0.3); 0.8043 (1.8); 0.7905 (4.7); 0.7840 (4.7); 0.7738 (4.7); 0.7672 (4.4); 0.7517
(1.5); 0.0632 (0.5); 0.0269 (0.4); 0.0161 (12.2); 0.0049 (0.6); −0.0478 (2.8)
1-078: ¹H-NMR(300.2 MHz, CDCl3):
δ = 7.3272 (0.5); 7.2987 (3.5); 7.2747 (0.8); 7.0122 (0.4); 7.0093 (0.6); 7.0044 (0.5); 7.0015 (0.7);
6.9863 (0.9); 6.9775 (0.5); 6.9744 (0.6); 6.9627 (0.7); 6.9354 (0.8); 6.9290 (1.0); 6.9223 (0.5); 5.4152
(0.6); 5.3943 (0.8); 5.3735 (0.6); 2.6494 (16.0); 2.4422 (8.7); 1.9302 (0.6); 1.6585 (0.4); 1.4341 (8.6);
1.4132 (8.7); 1.3939 (0.4); 1.3869 (0.4); 1.0290 (0.4); 1.0139 (1.0); 1.0070 (1.0); 1.0013 (0.5); 0.9921
(0.6); 0.9855 (1.0); 0.9789 (0.8); 0.9642 (0.4); 0.7569 (0.5); 0.7418 (1.2); 0.7355 (1.0); 0.7254 (1.0);
0.7195 (1.2); 0.7032 (0.4); 0.0355 (3.1)
1-079: ¹H-NMR(400.1 MHz, d₆-DMSO):
δ = 8.3115 (5.9); 7.7517 (0.6); 7.7318 (2.1); 7.7143 (3.6); 7.6877 (2.5); 7.6688 (1.2); 7.6300 (1.8);
7.6098 (1.2); 3.9368 (16.0); 3.3278 (5.3); 2.5097 (0.8)
1-080: ¹H-NMR(300.2 MHz, CDCl3):
δ = 7.3109 (0.8); 7.2987 (4.7); 7.2848 (1.4); 7.2586 (0.9); 7.0014 (0.6); 6.9984 (0.7); 6.9936 (0.8);
6.9906 (0.8); 6.9709 (1.1); 6.9665 (1.4); 6.9405 (0.8); 6.9259 (1.1); 6.9195 (1.2); 6.9129 (0.6); 5.4044
(0.7); 5.3835 (0.9); 5.3626 (0.7); 3.7427 (16.0); 2.6631 (0.6); 2.6431 (9.0); 2.3405 (9.2); 2.2666 (0.4);
2.0823 (0.5); 1.9509 (0.3); 1.9398 (0.4); 1.9229 (0.7); 1.9061 (0.4); 1.8950 (0.4); 1.4311 (0.4); 1.4202
(11.0); 1.3993 (10.9); 1.2954 (0.5); 1.0104 (0.5); 0.9954 (1.1); 0.9883 (1.3); 0.9826 (0.7); 0.9736
(0.7); 0.9669 (1.2); 0.9600 (1.1); 0.9457 (0.6); 0.7549 (0.6); 0.7399 (1.4); 0.7334 (1.3); 0.7234 (1.2);
0.7176 (1.5); 0.7012 (0.5); 0.4732 (1.4); 0.3153 (2.9); 0.1064 (0.4); 0.0358 (4.7)
1-081: ¹H-NMR(300.2 MHz, d₆-DMSO):
δ = 12.4164 (0.4); 9.3565 (0.4); 7.3562 (6.8); 7.3301 (15.4); 7.3039 (9.4); 7.2752 (0.9); 7.2503 (0.5);
7.0529 (0.5); 7.0373 (0.6); 7.0158 (9.1); 7.0118 (8.1); 6.9860 (12.4); 6.9779 (9.5); 6.9750 (8.0);
6.9596 (4.6); 6.9562 (5.0); 6.9515 (10.2); 6.9483 (9.1); 6.9417 (13.6); 6.9361 (14.8); 6.9295 (7.4);
6.8903 (1.2); 6.5383 (0.3); 6.5193 (0.6); 6.4942 (0.4); 6.4631 (0.5); 6.4561 (0.6); 6.4496 (0.3); 4.0848
(0.3); 4.0611 (1.0); 4.0374 (1.0); 4.0135 (0.4); 3.0156 (0.9); 2.6205 (0.4); 2.5614 (5.1); 2.5342 (6.9);
2.5281 (14.7); 2.5221 (20.4); 2.5160 (15.0); 2.5100 (7.3); 2.4708 (0.5); 2.4047 (94.7); 2.3577 (1.4);
2.3372 (0.6); 2.2181 (6.5); 2.1853 (0.6); 2.0997 (4.5); 2.0161 (1.7); 2.0089 (4.6); 1.9993 (3.6); 1.9882
(3.9); 1.9830 (2.9); 1.9716 (7.4); 1.9600 (3.2); 1.9548 (4.5); 1.9437 (4.5); 1.9296 (14.1); 1.8218 (0.4);
1.2184 (1.1); 1.1947 (2.2); 1.1709 (1.1); 1.0134 (4.4); 0.9989 (12.5); 0.9913 (14.0); 0.9857 (7.6);
0.9777 (8.1); 0.9708 (14.0); 0.9632 (13.4); 0.9499 (6.6); 0.9355 (0.9); 0.9262 (1.3); 0.9182 (0.9);
0.8977 (1.0); 0.8900 (0.7); 0.8770 (0.4); 0.7850 (0.5); 0.7674 (0.5); 0.7347 (5.6); 0.7208 (14.0);
0.7178 (11.9); 0.7138 (15.0); 0.7042 (14.3); 0.6973 (16.0); 0.6822 (5.6); 0.6626 (0.8); 0.6504 (0.6);
0.6350 (0.5); 0.6291 (0.5); 0.6155 (0.8); 0.6083 (0.8); 0.5988 (0.8); 0.5915 (0.8); 0.5770 (0.3); 0.1053
(0.5); 0.0306 (0.7); 0.0198 (22.5); 0.0088 (1.0); −0.0406 (1.4)
1-082: ¹H-NMR(400.1 MHz, CDCl3):
δ = 7.5310 (0.4); 7.5109 (1.2); 7.4911 (1.8); 7.4829 (1.9); 7.4692 (2.3); 7.4189 (1.2); 7.3997 (0.7);
7.2594 (7.0); 3.9970 (16.0); 2.6349 (13.6); 2.3177 (13.5); 1.5482 (6.2); −0.0002 (6.0)
1-083: ¹H-NMR(499.9 MHz, CDCl3):
δ = 7.7555 (5.2); 7.5543 (0.6); 7.5387 (1.5); 7.5229 (1.4); 7.5038 (1.7); 7.4877 (0.9); 7.4753 (1.9);
7.4262 (1.1); 7.4103 (0.8); 7.2609 (3.6); 4.4644 (1.4); 4.4501 (3.9); 4.4359 (3.9); 4.4216 (1.3); 2.6740
(16.0); 1.5512 (1.8); 1.4201 (4.1); 1.4058 (8.0); 1.3915 (3.9); 0.0059 (0.3); −0.0002 (4.2)
1-084: ¹H-NMR(300.2 MHz, CDCl3):
δ = 8.2471 (2.2); 8.2382 (2.2); 7.8875 (2.2); 7.8822 (2.4); 7.6695 (0.6); 7.6627 (0.6); 7.6517 (0.4);
7.6260 (1.1); 7.6041 (3.5); 7.5820 (0.4); 7.5616 (1.8); 7.5215 (0.8); 7.5123 (1.2); 7.5049 (0.7); 7.4906
(0.7); 7.4833 (0.4); 7.3042 (11.7); 6.6688 (1.5); 6.6627 (1.7); 6.6600 (1.6); 6.6540 (1.4); 6.4075 (0.3);
4.1067 (0.3); 4.0306 (1.6); 3.9255 (16.0); 3.7521 (0.5); 1.6043 (0.4); 0.0536 (0.4); 0.0428 (11.8);
0.0319 (0.4)
1-085: ¹H-NMR(300.2 MHz, CDCl3):
δ = 7.6203 (1.0); 7.5965 (3.7); 7.5908 (2.4); 7.5804 (2.4); 7.5786 (2.4); 7.5688 (4.0); 7.5603 (3.7);
7.5442 (8.2); 7.5355 (1.8); 7.5333 (1.9); 7.5255 (0.9); 7.5190 (0.7); 7.5166 (0.7); 7.5106 (0.7); 7.5027
(0.4); 7.4599 (0.5); 7.4479 (0.4); 7.4361 (2.1); 7.4283 (2.1); 7.4194 (1.6); 7.4163 (2.0); 7.4110 (1.1);
7.4076 (1.0); 7.4038 (1.3); 7.3014 (3.6); 4.1011 (0.4); 3.7961 (4.1); 3.7421 (16.0); 1.6023 (2.3);
0.0411 (2.9)
1-086: ¹H-NMR(400.1 MHz, CDCl3):
δ = 8.6013 (3.0); 8.5973 (2.8); 8.5141 (2.8); 8.5086 (2.8); 7.9647 (5.2); 7.8504 (0.4); 7.8267 (1.6);
7.8215 (2.7); 7.8164 (1.6); 7.6276 (0.7); 7.2734 (0.9); 4.0351 (2.5); 4.0229 (16.0); −0.0002 (0.8)
1-087: ¹H-NMR(499.9 MHz, CDCl3):
δ = 7.5580 (0.4); 7.5425 (1.5); 7.5268 (3.1); 7.5088 (0.6); 7.4751 (2.1); 7.4226 (1.3); 7.4079 (1.0);
7.2602 (3.1); 4.0240 (16.0); 2.4323 (15.4); 1.5511 (4.0); −0.0002 (3.2)
1-088: ¹H-NMR(300.2 MHz, CDCl3):
δ = 8.8513 (3.1); 8.8181 (2.8); 8.8097 (2.8); 8.0119 (10.8); 7.9514 (0.4); 7.9336 (1.6); 7.9271 (2.8);
7.9205 (1.6); 7.6933 (1.4); 7.2997 (27.9); 4.5816 (0.4); 4.5688 (2.4); 4.5577 (1.1); 4.5450 (7.4);
4.5339 (1.3); 4.5212 (7.5); 4.5100 (0.6); 4.4975 (2.4); 3.1500 (0.6); 1.5927 (10.0); 1.5229 (1.1);
1.5050 (7.9); 1.4992 (2.6); 1.4812 (16.0); 1.4574 (7.6); 0.0494 (1.0); 0.0386 (29.1); 0.0276 (0.9)
1-089: ¹H-NMR(300.2 MHz, CDCl3):
δ = 10.3815 (3.7); 7.9584 (5.4); 7.8619 (0.6); 7.8561 (0.6); 7.8420 (0.6); 7.8360 (1.2); 7.8300 (0.8);
7.8158 (0.7); 7.8101 (0.7); 7.6472 (0.6); 7.6415 (0.6); 7.6208 (1.1); 7.6162 (1.0); 7.5959 (0.8); 7.5901
(0.7); 7.3977 (0.8); 7.3711 (1.3); 7.3446 (0.6); 7.2985 (2.2); 5.4175 (0.4); 5.3966 (1.0); 5.3757 (1.4);
5.3549 (1.1); 5.3341 (3.7); 1.6217 (1.4); 1.4694 (15.8); 1.4486 (16.0); 1.4290 (0.6); 1.2554 (0.5);
1.2348 (0.5); 1.2138 (0.4); 1.1934 (0.4); 0.0327 (2.7)
1-090: ¹H-NMR(300.2 MHz, CDCl3):
δ = 7.9090 (5.7); 7.4635 (0.5); 7.4573 (0.5); 7.4388 (0.7); 7.4325 (1.0); 7.4187 (0.6); 7.4101 (0.6);
7.2987 (4.3); 7.2564 (0.4); 7.2358 (1.0); 7.2296 (0.8); 7.2154 (1.2); 7.2085 (2.4); 7.1828 (1.2); 7.1565
(0.4); 6.9290 (0.8); 6.8917 (0.8); 6.8700 (0.9); 6.8327 (0.9); 5.9082 (1.5); 5.9052 (1.6); 5.8492 (1.4);
5.8461 (1.4); 5.4700 (1.5); 5.4669 (1.5); 5.4326 (1.4); 5.4296 (1.5); 5.4042 (0.4); 5.3834 (1.0); 5.3625
(1.4); 5.3417 (1.0); 5.3208 (0.4); 1.5941 (1.2); 1.4579 (16.0); 1.4370 (15.8); 1.2576 (0.4); 1.2371
(0.4); 0.0374 (5.4)
1-091: ¹H-NMR(300.2 MHz, CDCl3):
δ = 7.9042 (6.5); 7.8828 (0.8); 7.8781 (1.4); 7.8742 (1.0); 7.8317 (1.3); 7.8250 (1.8); 7.8191 (1.2);
7.6000 (1.0); 7.5735 (2.1); 7.5474 (1.4); 7.4917 (1.0); 7.4882 (1.1); 7.4837 (1.0); 7.4803 (1.0); 7.4646
(0.6); 7.4611 (0.6); 7.4567 (0.6); 7.4532 (0.6); 7.2987 (2.1); 5.3974 (0.4); 5.3766 (1.0); 5.3557 (1.4);
5.3333 (3.8); 5.3140 (0.4); 2.6431 (16.0); 1.6372 (1.8); 1.4490 (15.6); 1.4281 (15.4); 1.2518 (0.7);
1.2314 (0.7); 0.0329 (2.6)
1-092: ¹H-NMR(300.2 MHz, d₆-DMSO):
δ = 8.2774 (16.0); 7.6494 (1.3); 7.6440 (1.5); 7.6200 (2.6); 7.6018 (1.6); 7.5956 (1.5); 7.4034 (1.1);
7.3977 (1.2); 7.3764 (2.7); 7.3719 (2.5); 7.3528 (2.5); 7.3465 (2.0); 7.3256 (3.5); 7.2990 (3.9); 7.2722
(1.3); 6.9157 (2.1); 6.8783 (2.4); 6.8566 (2.6); 6.8192 (2.6); 6.0381 (4.1); 6.0355 (4.2); 5.9792 (3.6);
5.9764 (3.6); 5.5463 (4.2); 5.5439 (4.0); 5.5088 (3.8); 5.5062 (4.0); 4.0604 (0.6); 4.0367 (0.6); 2.5346
(2.0); 2.5287 (4.3); 2.5226 (6.1); 2.5166 (4.5); 2.5107 (2.1); 2.0087 (2.5); 1.9299 (0.4); 1.2176 (0.6);
1.1939 (1.3); 1.1702 (0.6); 0.0183 (5.9)
1-093: ¹H-NMR(300.2 MHz, d₆-DMSO):
δ = 8.2492 (16.0); 7.9235 (2.0); 7.9194 (3.4); 7.9151 (2.4); 7.8982 (2.5); 7.8938 (4.0); 7.8896 (2.8);
7.8121 (3.8); 7.8053 (5.4); 7.7994 (3.7); 7.6781 (2.8); 7.6514 (6.0); 7.6257 (4.0); 7.5801 (3.0); 7.5765
(3.4); 7.5722 (3.1); 7.5687 (3.0); 7.5530 (1.8); 7.5495 (1.7); 7.5451 (1.8); 7.5416 (1.5); 2.6174 (40.6);
2.5452 (0.4); 2.5346 (2.5); 2.5287 (5.3); 2.5226 (7.3); 2.5166 (5.3); 2.5108 (2.5); 2.0092 (0.5); 0.0197 (6.4)
1-094: ¹H-NMR(300.2 MHz, d₆-DMSO):
δ = 8.2283 (11.5); 7.8419 (0.8); 7.4747 (1.7); 7.4667 (0.6); 7.4491 (3.9); 7.4231 (2.4); 7.2487 (0.5);
7.2326 (3.6); 7.2059 (2.7); 7.1863 (6.8); 7.1595 (2.1); 7.1523 (1.6); 4.0848 (1.1); 4.0611 (3.4); 4.0374
(3.5); 4.0137 (1.2); 3.3580 (1.2); 3.1347 (1.0); 3.1004 (1.6); 3.0916 (1.1); 3.0667 (1.4); 3.0534 (1.2);
3.0236 (1.0); 2.5346 (5.0); 2.5287 (10.8); 2.5227 (14.8); 2.5167 (10.8); 2.5109 (5.0); 2.0656 (2.2);
2.0476 (1.5); 2.0351 (2.8); 2.0282 (2.6); 2.0200 (1.6); 2.0097 (16.0); 2.0008 (3.4); 1.9886 (1.1);
1.9772 (1.1); 1.9665 (1.2); 1.9296 (14.7); 1.2186 (4.0); 1.1949 (7.8); 1.1711 (3.8); 0.0310 (0.6);
0.0202 (17.6); 0.0092 (0.6)
1-095: ¹H-NMR(300.2 MHz, d₆-DMSO):
δ = 8.2172 (16.0); 7.8172 (1.1); 7.5335 (0.4); 7.5209 (2.7); 7.5083 (1.1); 7.4950 (5.9); 7.4813 (1.3);
7.4687 (4.0); 7.4323 (0.4); 7.2414 (0.8); 7.2065 (8.3); 7.1989 (5.9); 7.1802 (5.2); 7.1726 (5.8); 7.1660
(6.8); 7.1604 (6.4); 5.7866 (0.5); 5.5279 (0.3); 5.4410 (0.6); 5.2844 (0.6); 4.0613 (0.8); 4.0377 (0.8);
4.0142 (0.4); 3.6447 (0.3); 3.3505 (11.6); 3.2182 (0.8); 3.1169 (0.4); 2.7483 (0.5); 2.5853 (0.4);
2.5346 (21.8); 2.5287 (46.6); 2.5227 (64.6); 2.5167 (46.8); 2.5108 (21.7); 2.2933 (0.4); 2.0100 (3.1);
1.9297 (5.9); 1.7140 (0.4); 1.5738 (1.3); 1.5537 (4.9); 1.5468 (4.9); 1.5277 (1.9); 1.5086 (1.4); 1.4880
(4.7); 1.4816 (5.0); 1.4631 (2.0); 1.3997 (0.4); 1.2828 (0.4); 1.2537 (2.2); 1.2318 (5.2); 1.2236 (6.3);
1.2011 (6.3); 1.1951 (6.3); 1.1713 (2.0); 0.2153 (0.4); 0.0318 (2.5); 0.0208 (76.8); 0.0098 (2.6)
1-096: ¹H-NMR(300.2 MHz, CDCl3):
δ = 7.8773 (5.0); 7.5112 (0.5); 7.4447 (0.9); 7.4317 (0.3); 7.4179 (1.9); 7.3924 (1.4); 7.2989 (5.8);
7.2244 (0.6); 7.1980 (0.5); 7.1791 (2.4); 7.1725 (2.7); 7.1462 (2.4); 7.1348 (1.8); 7.1302 (1.8); 6.8524
(0.3); 6.7354 (0.5); 5.3906 (0.4); 5.3698 (1.0); 5.3489 (1.4); 5.3280 (1.0); 5.3072 (0.4); 4.8971 (1.1);
2.8573 (0.4); 2.8298 (0.5); 2.8166 (0.6); 2.7896 (0.7); 2.7743 (0.5); 2.7474 (0.6); 1.9123 (0.4); 1.8971
(0.7); 1.8825 (0.6); 1.8724 (0.7); 1.8575 (0.8); 1.8424 (0.4); 1.8327 (0.5); 1.8161 (0.5); 1.7111 (0.4);
1.6977 (0.4); 1.6842 (0.7); 1.6703 (1.0); 1.6563 (0.7); 1.6427 (0.9); 1.6287 (0.8); 1.6157 (0.4); 1.5989
(5.8); 1.4677 (1.6); 1.4435 (16.0); 1.4226 (15.5); 1.3048 (1.4); 0.9417 (0.5); 0.9202 (1.4); 0.8971
(0.6); 0.0381 (7.6); 0.0278 (0.3)
1-097: ¹H-NMR(300.2 MHz, CDCl3):
δ = 7.8774 (4.8); 7.8763 (4.8); 7.5175 (0.7); 7.4681 (0.7); 7.4420 (1.6); 7.4164 (0.9); 7.2999 (5.3);
7.2987 (5.2); 7.1733 (4.2); 7.1458 (2.4); 7.1188 (1.3); 5.3926 (0.4); 5.3715 (1.0); 5.3635 (0.4); 5.3507
(1.3); 5.3300 (1.2); 5.3091 (0.4); 1.5965 (4.9); 1.5767 (1.5); 1.5715 (1.5); 1.5498 (0.6); 1.5350 (0.6);
1.5130 (1.6); 1.5078 (1.6); 1.4867 (0.7); 1.4693 (2.5); 1.4462 (16.0); 1.4250 (14.6); 1.4046 (0.4);
1.1657 (0.6); 1.1437 (1.7); 1.1387 (2.1); 1.1150 (2.0); 1.1095 (1.8); 1.0871 (0.5); 0.0391 (7.1); 0.0378 (6.9)
1-098: ¹H-NMR(400.2 MHz, d₆-DMSO):
δ = 7.9623 (6.0); 7.6160 (0.7); 7.5966 (1.6); 7.5764 (1.0); 7.4675 (1.5); 7.4482 (1.1); 7.3796 (3.6);
7.3605 (1.0); 7.3580 (1.0); 7.3551 (0.8); 7.1942 (1.2); 7.0549 (2.5); 6.9157 (1.2); 2.6233 (16.0);
2.5112 (1.7); 2.5069 (3.6); 2.5024 (4.8); 2.4979 (3.4); 2.4936 (1.6); −0.0002 (5.2)
1-099: ¹H-NMR(499.9 MHz, d₆-DMSO):
δ = 8.3652 (0.5); 8.3013 (6.0); 7.2138 (0.4); 7.2107 (0.5); 7.1975 (1.3); 7.1847 (1.3); 7.1784 (2.3);
7.1627 (2.0); 7.1467 (0.8); 6.9469 (0.8); 6.9441 (0.8); 6.9294 (1.3); 6.9191 (0.7); 6.9151 (0.6); 3.9505
(16.0); 3.9442 (2.6); 3.3320 (0.5); 2.0788 (0.6); 2.0722 (0.6); 2.0621 (1.1); 2.0519 (0.7); 2.0454 (0.6);
1.0310 (0.7); 1.0222 (2.1); 1.0179 (2.3); 1.0095 (1.3); 1.0053 (2.2); 1.0011 (2.2); 0.9928 (0.9); 0.7914
(0.9); 0.7828 (2.5); 0.7792 (2.6); 0.7728 (2.5); 0.7690 (2.6); 0.7599 (0.8)
1-100: ¹H-NMR(400.2 MHz, d₆-DMSO):
δ = 8.0224 (4.7); 7.1588 (2.4); 7.1510 (1.6); 7.1480 (1.6); 7.1398 (2.7); 6.9293 (0.5); 6.9213 (0.6);
6.9129 (0.9); 6.9049 (0.9); 6.8970 (0.5); 6.8887 (0.4); 3.9282 (16.0); 3.3313 (3.9); 2.6229 (13.6);
2.5126 (1.4); 2.5082 (2.8); 2.5037 (3.8); 2.4992 (2.8); 2.4949 (1.4); 2.0704 (0.5); 2.0622 (0.5); 2.0495
(0.9); 2.0366 (0.6); 2.0285 (0.5); 1.0304 (0.6); 1.0194 (1.7); 1.0139 (1.8); 1.0097 (1.0); 1.0037 (1.0);
0.9983 (1.7); 0.9929 (1.8); 0.9827 (0.7); 0.7902 (0.8); 0.7798 (1.9); 0.7748 (2.1); 0.7671 (1.9); 0.7620
(2.0); 0.7508 (0.6); 0.0000 (2.1)
1-101: ¹H-NMR(400.2 MHz, d₆-DMSO):
δ = 7.2043 (0.4); 7.1889 (1.2); 7.1841 (1.1); 7.1760 (3.2); 7.1676 (1.3); 7.1591 (2.1); 7.1386 (0.6);
6.9595 (0.7); 6.9548 (0.7); 6.9418 (1.0); 6.9354 (1.0); 6.9272 (0.6); 6.9189 (0.5); 3.9980 (16.0);
3.3447 (16.6); 2.5161 (0.8); 2.5119 (1.6); 2.5075 (2.2); 2.5030 (1.6); 2.4028 (14.4); 2.0802 (0.8);
2.0755 (0.5); 2.0671 (0.5); 2.0545 (1.0); 2.0417 (0.6); 2.0335 (0.5); 1.0366 (0.6); 1.0256 (1.8); 1.0201
(2.0); 1.0158 (1.0); 1.0099 (1.0); 1.0045 (1.9); 0.9991 (1.9); 0.9889 (0.8); 0.7930 (0.8); 0.7825 (2.1);
0.7800 (1.9); 0.7775 (2.2); 0.7699 (2.0); 0.7648 (2.2); 0.7535 (0.6); 0.0000 (1.1)
1-102: ¹H-NMR(300.2 MHz, CDCl3):
δ = 8.7280 (1.2); 8.7058 (1.4); 7.9581 (5.4); 7.8378 (1.4); 7.2988 (5.6); 6.9909 (0.9); 6.8055 (1.9);
6.6200 (1.0); 5.4140 (0.4); 5.3931 (1.0); 5.3722 (1.4); 5.3514 (1.0); 5.3305 (0.4); 1.6191 (3.5); 1.4842
(0.5); 1.4636 (16.0); 1.4427 (15.5); 1.3423 (0.4); 1.3024 (2.4); 0.9393 (0.9); 0.9176 (2.7); 0.8943
(1.0); 0.1059 (1.1); 0.0355 (6.8)
1-103: ¹H-NMR(400.1 MHz, d₆-DMSO):
δ = 7.4511 (1.2); 7.4315 (2.6); 7.4117 (1.6); 7.2106 (2.1); 7.1913 (1.8); 7.1592 (3.0); 7.1422 (1.9);
7.1219 (1.5); 5.3106 (0.5); 5.2949 (1.2); 5.2793 (1.6); 5.2638 (1.2); 5.2482 (0.5); 3.3097 (8.2); 3.1096
(0.6); 3.0851 (1.0); 3.0578 (0.8); 3.0503 (0.9); 3.0261 (0.6); 2.5093 (4.8); 2.3947 (14.7); 2.0352 (1.3);
2.0099 (2.1); 1.9891 (2.1); 1.9644 (1.2); 1.3721 (0.4); 1.3553 (0.6); 1.3341 (16.0); 1.3186 (15.7)
1-104: ¹H-NMR(300.2 MHz, d₆-DMSO):
δ = 7.5079 (5.9); 7.4818 (13.3); 7.4555 (8.1); 7.1921 (9.6); 7.1665 (14.2); 7.1621 (16.0); 7.1403 (4.8);
7.1352 (9.6); 7.1228 (13.0); 7.1168 (15.1); 4.0615 (0.7); 4.0382 (0.7); 4.0142 (0.4); 3.8911 (0.3);
3.8778 (0.3); 3.8051 (0.3); 3.6746 (0.5); 3.6270 (0.8); 3.6045 (0.9); 3.5980 (0.9); 3.3483 (4.0); 3.0543
(0.6); 3.0361 (0.6); 3.0206 (0.5); 2.9179 (0.3); 2.7496 (0.6); 2.5982 (0.5); 2.5348 (24.9); 2.5288
(54.8); 2.5228 (77.0); 2.5168 (56.6); 2.5109 (26.9); 2.4534 (0.6); 2.3817 (95.8); 2.3423 (0.8); 2.3139
(0.7); 2.2941 (0.5); 2.2137 (0.5); 2.1626 (0.5); 2.0976 (0.8); 2.0102 (2.8); 1.9299 (5.1); 1.5677 (3.1);
1.5475 (9.6); 1.5410 (10.8); 1.5219 (4.3); 1.5030 (3.2); 1.4836 (9.7); 1.4759 (10.8); 1.4571 (4.6);
1.3936 (0.6); 1.3114 (0.6); 1.2803 (1.0); 1.2518 (4.8); 1.2297 (11.0); 1.2213 (13.4); 1.2028 (9.2);
1.1987 (13.4); 1.1907 (11.2); 1.1716 (3.7); 1.1432 (0.6); 1.1317 (0.5); 1.1126 (0.4); 1.1006 (0.3);
0.2163 (0.3); 0.0318 (2.0); 0.0209 (77.6); 0.0101 (2.9); −0.0451 (0.5)
1-105: ¹H-NMR(400.1 MHz, d₆-DMSO):
δ = 7.4345 (1.4); 7.4150 (3.0); 7.3953 (1.8); 7.1961 (2.4); 7.1769 (2.0); 7.1360 (3.7); 7.1257 (2.5);
7.1052 (1.7); 3.0932 (0.7); 3.0678 (1.2); 3.0413 (1.1); 3.0331 (1.0); 3.0096 (0.7); 2.4991 (5.8); 2.3697
(16.0); 2.0205 (1.5); 1.9950 (2.5); 1.9857 (1.2); 1.9739 (2.5); 1.9487 (0.9); 1.9068 (4.6); −0.0002 (2.1)
1-106: ¹H-NMR(300.2 MHz, CDCl3):
δ = 7.4486 (0.6); 7.4231 (1.3); 7.3976 (0.8); 7.3944 (0.7); 7.2989 (7.9); 7.1642 (3.1); 7.1609 (3.9);
7.1357 (1.3); 7.1290 (1.8); 7.1025 (1.0); 5.4474 (0.4); 5.4265 (1.0); 5.4056 (1.4); 5.3847 (1.0); 5.3639
(0.4); 2.4549 (16.0); 1.5912 (8.8); 1.5701 (1.4); 1.5647 (1.5); 1.5597 (0.8); 1.5449 (0.5); 1.5416 (0.4);
1.5304 (0.4); 1.5271 (0.4); 1.5065 (1.4); 1.5009 (1.5); 1.4959 (0.8); 1.4813 (0.6); 1.4417 (15.8);
1.4208 (15.7); 1.1589 (0.4); 1.1555 (0.5); 1.1408 (0.8); 1.1358 (1.5); 1.1299 (1.7); 1.1062 (1.8);
1.1011 (1.4); 1.0798 (0.4); 1.0765 (0.4); 0.0378 (9.4); 0.0268 (0.4)
1-107: ¹H-NMR(300.2 MHz, CDCl3):
δ = 7.9179 (6.4); 7.6094 (0.4); 7.2986 (12.0); 7.2758 (0.9); 7.2703 (0.8); 7.2528 (0.8); 7.2468 (0.8);
7.2235 (0.9); 7.1975 (1.4); 7.1945 (1.4); 7.1706 (0.7); 7.1679 (0.8); 7.1405 (0.6); 7.1375 (0.6); 7.1348
(0.6); 7.1165 (0.8); 7.1141 (0.7); 5.4071 (0.4); 5.3862 (1.1); 5.3653 (1.4); 5.3445 (1.1); 5.3236 (0.4);
2.9082 (0.3); 2.8949 (0.6); 2.8677 (0.6); 2.8544 (0.3); 2.8268 (0.3); 1.9830 (0.3); 1.9734 (0.4); 1.9603
(0.6); 1.9564 (0.5); 1.9434 (0.6); 1.9339 (0.7); 1.9207 (0.4); 1.9168 (0.7); 1.8944 (0.4); 1.8772 (0.3);
1.7473 (0.3); 1.7342 (0.4); 1.7204 (0.6); 1.7069 (0.8); 1.6927 (0.6); 1.6785 (0.7); 1.6652 (0.6); 1.6511
(0.4); 1.5844 (7.9); 1.4782 (1.3); 1.4618 (16.0); 1.4409 (15.7); 0.0481 (0.4); 0.0433 (0.4); 0.0374
(14.2); 0.0297 (0.4); 0.0280 (0.4); 0.0265 (0.5)
1-108: ¹H-NMR(300.2 MHz, d₆-DMSO):
δ = 7.5552 (3.0); 7.2775 (0.6); 7.2745 (0.6); 7.2662 (1.2); 7.2488 (2.2); 7.2366 (0.8); 7.2264 (1.0);
7.2165 (0.5); 7.2005 (0.4); 3.3478 (16.0); 3.1018 (0.4); 3.0737 (0.4); 2.5340 (2.9); 2.5281 (6.1);
2.5220 (8.3); 2.5160 (6.1); 2.5101 (2.9); 2.0921 (0.6); 2.0769 (0.4); 2.0710 (0.5); 2.0636 (0.4); 2.0544
(0.4); 2.0477 (0.6); 2.0339 (0.4); 2.0199 (0.4); 2.0092 (0.5); 1.6200 (0.5); 0.0312 (0.4); 0.0204 (11.4);
0.0095 (0.5)
1-109: ¹H-NMR(300.2 MHz, CDCl3):
δ = 7.9172 (0.6); 7.2981 (5.1); 7.2842 (0.6); 7.2625 (1.2); 7.2397 (0.9); 7.2341 (1.0); 7.2004 (1.0);
7.1740 (1.8); 7.1470 (1.0); 7.1173 (1.0); 7.0966 (1.1); 7.0713 (0.4); 5.4608 (0.4); 5.4399 (1.1); 5.4190
(1.4); 5.3981 (1.1); 5.3773 (0.4); 2.9312 (0.4); 2.9033 (0.5); 2.8906 (0.8); 2.8629 (0.9); 2.8501 (0.5);
2.8224 (0.5); 2.4670 (16.0); 2.4551 (1.6); 2.2082 (8.2); 1.9938 (0.3); 1.9766 (0.4); 1.9673 (0.4);
1.9540 (0.7); 1.9371 (0.7); 1.9278 (0.7); 1.9110 (0.8); 1.8974 (0.4); 1.8882 (0.4); 1.8710 (0.4); 1.7393
(0.4); 1.7261 (0.4); 1.7122 (0.6); 1.6988 (0.9); 1.6847 (0.7); 1.6707 (0.9); 1.6571 (0.7); 1.6434 (0.4);
1.6300 (0.3); 1.6007 (4.9); 1.4817 (1.2); 1.4683 (1.5); 1.4570 (14.6); 1.4361 (14.0); 1.2956 (0.5);
0.9183 (0.4); 0.0361 (3.6)
1-110: ¹H-NMR(300.2 MHz, d₆-DMSO):
δ = 8.2790 (2.3); 7.4340 (0.6); 7.4198 (2.0); 7.4024 (3.7); 7.3950 (2.2); 7.3866 (4.6); 7.3720 (2.9);
7.3623 (3.1); 7.3269 (1.8); 7.3015 (16.0); 7.2845 (9.6); 7.2771 (8.0); 7.2585 (1.1); 3.6128 (0.3);
3.5872 (0.4); 3.3811 (0.8); 3.3129 (0.7); 3.2895 (0.7); 3.1978 (0.4); 3.1540 (1.7); 3.1237 (2.2); 3.1138
(3.0); 3.0836 (3.1); 3.0453 (1.9); 2.9110 (2.3); 2.7518 (2.1); 2.7092 (1.2); 2.5340 (13.1); 2.5280
(28.4); 2.5219 (39.3); 2.5158 (28.3); 2.5100 (13.3); 2.4263 (55.4); 2.4070 (3.8); 2.3600 (0.4); 2.2074
(0.4); 2.1720 (0.7); 2.1441 (1.7); 2.1347 (1.0); 2.1229 (2.1); 2.1062 (4.3); 2.0840 (4.2); 2.0712 (5.1);
2.0587 (2.6); 2.0447 (3.8); 2.0300 (2.4); 2.0159 (0.8); 2.0093 (1.0); 2.0035 (0.5); 1.9289 (1.1); 0.0307
(1.7); 0.0290 (0.9); 0.0275 (1.2); 0.0199 (53.0); 0.0122 (1.8); 0.0107 (1.8); 0.0090 (1.9)
1-111: ¹H-NMR(499.9 MHz, d₆-DMSO):
δ = 7.9572 (6.3); 7.1617 (0.3); 7.1570 (0.4); 7.1478 (3.0); 7.1410 (1.9); 7.1387 (1.9); 7.1330 (2.8);
6.9088 (0.7); 6.9020 (0.7); 6.8961 (1.2); 6.8896 (1.1); 6.8827 (0.6); 6.8765 (0.5); 2.7404 (0.9); 2.6089
(16.0); 2.5168 (0.3); 2.5134 (0.6); 2.5098 (0.8); 2.5062 (0.6); 2.0661 (0.6); 2.0596 (0.7); 2.0494 (1.2);
2.0424 (0.5); 2.0391 (0.7); 2.0326 (0.6); 1.0221 (0.9); 1.0134 (2.3); 1.0091 (2.4); 1.0053 (1.3); 1.0007
(1.4); 0.9965 (2.2); 0.9922 (2.3); 0.9840 (0.9); 0.7812 (1.0); 0.7729 (2.5); 0.7706 (2.3); 0.7689 (2.6);
0.7627 (2.5); 0.7587 (2.5); 0.7498 (0.8)
1-112: ¹H-NMR(300.2 MHz, CDCl3):
δ = 7.7840 (4.1); 7.2987 (18.6); 7.1414 (0.4); 7.1348 (0.4); 7.1147 (1.2); 7.1077 (1.1); 7.0988 (2.6);
7.0868 (1.2); 7.0781 (1.7); 7.0501 (0.4); 6.8222 (0.6); 6.8160 (0.6); 6.7994 (0.9); 6.7902 (0.8); 6.7810
(0.5); 6.7691 (0.4); 4.5299 (1.2); 4.5062 (3.6); 4.4824 (3.6); 4.4586 (1.2); 2.7388 (14.0); 2.4130 (0.4);
2.2888 (0.4); 2.1435 (0.4); 2.1330 (0.5); 2.1158 (0.8); 2.0985 (0.4); 2.0878 (0.4); 1.5881 (16.0);
1.4814 (3.8); 1.4577 (7.7); 1.4339 (3.7); 1.2924 (0.4); 1.0457 (0.6); 1.0306 (1.5); 1.0236 (1.7); 1.0091
(0.9); 1.0019 (1.6); 0.9952 (1.5); 0.9809 (0.7); 0.8042 (0.8); 0.7894 (1.8); 0.7831 (1.8); 0.7722 (1.6);
0.7669 (1.8); 0.7503 (0.6); 0.0481 (1.1); 0.0373 (24.0); 0.0263 (1.0)
1-113: ¹H-NMR(300.2 MHz, d₆-DMSO):
δ = 8.2836 (1.4); 8.2772 (16.0); 8.0256 (0.8); 7.5855 (0.4); 7.5487 (1.7); 7.5442 (1.5); 7.5229 (3.8);
7.5103 (3.4); 7.5049 (3.4); 7.4983 (2.9); 7.4936 (2.4); 7.4892 (2.2); 7.4835 (2.2); 7.3768 (2.8); 7.3503
(3.9); 7.3238 (1.6); 4.0603 (0.6); 4.0366 (0.6); 3.3605 (1.2); 3.2371 (0.6); 2.5342 (7.1); 2.5283 (15.8);
2.5223 (22.2); 2.5162 (16.4); 2.5104 (7.8); 2.0093 (2.6); 1.9292 (7.7); 1.5028 (1.0); 1.4759 (3.9);
1.4545 (1.6); 1.4402 (1.2); 1.4132 (4.0); 1.3921 (1.8); 1.2548 (0.4); 1.2247 (1.6); 1.2181 (1.1); 1.2027
(4.2); 1.1948 (5.8); 1.1732 (5.1); 1.1443 (1.2); 0.0302 (0.7); 0.0194 (25.5); 0.0085 (1.1)
1-114: ¹H-NMR(300.2 MHz, CDCl3):
δ = 7.9261 (0.4); 7.9166 (5.3); 7.6145 (0.4); 7.4855 (0.3); 7.4803 (0.5); 7.4756 (0.4); 7.4594 (0.9);
7.4543 (1.0); 7.4502 (0.6); 7.4386 (0.5); 7.4333 (0.6); 7.4286 (0.5); 7.3637 (0.4); 7.3600 (0.4); 7.3388
(1.0); 7.3366 (0.9); 7.3154 (0.8); 7.3128 (0.7); 7.3095 (0.7); 7.2990 (4.7); 7.2686 (1.1); 7.2422 (1.3);
7.2156 (0.5); 7.0516 (1.2); 7.0471 (0.8); 7.0317 (0.7); 7.0277 (0.4); 5.4051 (0.4); 5.3843 (1.0); 5.3634
(1.4); 5.3425 (1.0); 5.3217 (0.4); 5.2848 (0.6); 5.2686 (0.6); 1.6046 (3.3); 1.5156 (0.5); 1.4927 (1.6);
1.4894 (1.6); 1.4769 (1.7); 1.4597 (16.0); 1.4388 (15.7); 1.4037 (0.7); 1.3039 (1.0); 1.2341 (0.6);
1.2131 (1.4); 1.2057 (1.6); 1.1833 (1.7); 1.1758 (1.3); 1.1636 (0.5); 1.1557 (0.8); 1.1340 (0.5); 1.1287
(0.4); 0.9410 (0.3); 0.9194 (1.1); 0.8961 (0.4); 0.0375 (6.0)
1-115: ¹H-NMR(300.2 MHz, CDCl3):
δ = 7.4720 (0.4); 7.4670 (0.6); 7.4621 (0.4); 7.4457 (0.9); 7.4409 (1.0); 7.4252 (0.5); 7.4199 (0.6);
7.4152 (0.5); 7.3599 (0.3); 7.3545 (0.4); 7.3508 (0.4); 7.3296 (0.9); 7.3275 (0.9); 7.2991 (13.2);
7.2490 (0.9); 7.2224 (1.2); 7.1957 (0.5); 7.0557 (1.4); 7.0506 (1.0); 7.0353 (0.7); 7.0309 (0.4); 5.4608
(0.4); 5.4399 (1.0); 5.4191 (1.3); 5.3982 (1.0); 5.3773 (0.4); 5.2403 (0.8); 5.2239 (0.8); 2.4655 (15.5);
2.4545 (1.8); 1.5914 (11.8); 1.5121 (0.4); 1.4898 (1.6); 1.4817 (2.4); 1.4570 (16.0); 1.4361 (15.8);
1.4231 (1.7); 1.4001 (0.6); 1.3042 (1.3); 1.2301 (0.6); 1.2093 (1.4); 1.2019 (1.6); 1.1796 (1.6); 1.1717
(1.4); 1.1587 (0.6); 1.1516 (0.5); 1.1363 (0.6); 0.9417 (0.5); 0.9200 (1.4); 0.8966 (0.6); 0.0489 (0.5);
0.0380 (16.4); 0.0270 (0.6)
1-116: ¹H-NMR(499.9 MHz, d₆-DMSO):
δ = 7.2375 (1.0); 7.2279 (2.3); 7.2176 (2.2); 7.2080 (0.8); 7.1225 (1.6); 7.1069 (4.1); 7.0911 (4.0);
7.0819 (2.2); 7.0781 (2.4); 7.0644 (2.5); 7.0514 (1.1); 7.0481 (0.9); 6.8826 (1.6); 6.8789 (1.7); 6.8678
(2.6); 6.8537 (1.4); 6.8508 (1.2); 3.3246 (4.9); 2.9361 (16.0); 2.9258 (15.5); 2.5107 (4.0); 2.5072
(7.6); 2.5036 (10.0); 2.5000 (7.1); 2.4965 (3.3); 2.0717 (0.7); 2.0613 (1.3); 2.0547 (1.4); 2.0445 (2.4);
2.0343 (1.4); 2.0277 (1.2); 2.0173 (0.6); 1.9905 (0.7); 1.1768 (0.4); 1.0204 (2.0); 1.0117 (4.9); 1.0074
(5.0); 1.0037 (2.7); 0.9991 (2.7); 0.9948 (4.7); 0.9905 (4.7); 0.9823 (1.8); 0.7894 (0.4); 0.7702 (2.3);
0.7618 (5.3); 0.7597 (4.7); 0.7578 (5.5); 0.7516 (5.0); 0.7475 (5.2); 0.7386 (1.6)
1-117: ¹H-NMR(499.9 MHz, d₆-DMSO):
δ = 7.7080 (0.7); 7.6925 (1.4); 7.6727 (5.0); 7.6569 (9.6); 7.6416 (5.4); 7.6129 (5.4); 7.5990 (9.9);
7.5860 (6.4); 7.4613 (8.0); 7.4453 (12.7); 7.4293 (5.6); 7.3884 (1.4); 7.3802 (7.3); 7.2804 (2.9);
7.2721 (16.0); 7.1723 (1.4); 7.1640 (7.9); 4.0581 (0.6); 3.0700 (2.2); 2.5471 (0.5); 2.5071 (3.5);
2.5039 (4.7); 2.5006 (3.7); 2.4512 (0.4); 2.4180 (100.6); 2.4073 (17.9); 2.3005 (0.6); 2.2854 (0.6);
1.1096 (0.4); 1.0962 (6.9)
1-118: ¹H-NMR(300.2 MHz, CDCl3):
δ = 7.9331 (5.2); 7.6246 (0.4); 7.3831 (0.6); 7.3773 (0.6); 7.3617 (0.7); 7.3559 (1.3); 7.3506 (0.9);
7.3353 (0.7); 7.3292 (0.8); 7.2990 (0.6); 7.2884 (0.5); 7.2827 (0.5); 7.2666 (0.5); 7.2607 (1.4); 7.2552
(0.9); 7.2392 (1.0); 7.2330 (0.9); 7.1987 (1.2); 7.1940 (1.2); 7.1718 (1.3); 7.1668 (1.4); 7.1448 (0.5);
7.1395 (0.5); 5.3953 (0.4); 5.3744 (1.0); 5.3536 (1.4); 5.3327 (1.0); 5.3119 (0.4); 2.0723 (0.5); 1.4704
(1.4); 1.4512 (16.0); 1.4303 (15.1); 0.0315 (0.8)
1-119: ¹H-NMR(499.9 MHz, CDCl3):
δ = 7.9360 (16.0); 7.6226 (1.0); 7.3432 (2.2); 7.3407 (2.7); 7.3275 (4.4); 7.3144 (2.4); 7.3116 (2.7);
7.2617 (6.0); 7.2399 (2.1); 7.2374 (2.3); 7.2238 (4.5); 7.2103 (2.9); 7.2076 (2.9); 7.1903 (0.4); 7.1874
(0.4); 7.1586 (3.4); 7.1559 (3.5); 7.1423 (4.6); 7.1395 (4.8); 7.1259 (1.8); 7.1231 (1.9); 6.9462 (0.6);
6.9315 (1.3); 6.9279 (0.9); 6.9210 (0.4); 6.9170 (0.7); 6.9120 (0.6); 6.9051 (0.4); 6.8971 (0.6); 6.8926
(0.4); 5.4641 (1.1); 5.4561 (1.1); 4.5100 (0.9); 4.5010 (4.3); 4.4868 (11.6); 4.4725 (11.4); 4.4582
(3.8); 1.5785 (9.1); 1.4637 (1.5); 1.4455 (12.7); 1.4312 (23.5); 1.4169 (11.4); −0.0002 (6.6)
1-120: ¹H-NMR(499.9 MHz, CDCl3):
δ = 7.7348 (5.0); 7.3033 (0.7); 7.3005 (0.8); 7.2873 (1.5); 7.2843 (1.2); 7.2743 (0.9); 7.2714 (1.0);
7.2638 (2.0); 7.2379 (0.7); 7.2350 (0.8); 7.2214 (1.6); 7.2189 (1.2); 7.2080 (0.9); 7.2051 (1.0); 7.1317
(1.0); 7.1286 (1.1); 7.1153 (1.5); 7.1122 (1.7); 7.0989 (0.6); 7.0958 (0.7); 5.3387 (0.4); 5.3263 (1.1);
5.3137 (1.5); 5.3012 (1.2); 5.2887 (0.5); 2.7076 (15.4); 1.6075 (3.7); 1.4053 (16.0); 1.3927
(16.0); −0.0002 (1.9)
1-121: ¹H-NMR(499.9 MHz, d₆-DMSO):
δ = 7.6005 (1.3); 7.5979 (1.5); 7.5844 (2.8); 7.5709 (1.6); 7.5683 (1.6); 7.4782 (1.2); 7.4756 (1.4);
7.4615 (2.9); 7.4475 (1.8); 7.4449 (1.7); 7.3612 (1.9); 7.3584 (2.0); 7.3446 (3.0); 7.3419 (3.2); 7.3281
(1.3); 7.3254 (1.4); 4.4982 (2.4); 4.4840 (7.6); 4.4698 (7.7); 4.4556 (2.5); 3.3159 (12.1); 2.5070 (4.8);
2.5036 (6.5); 2.5004 (5.1); 2.4165 (28.2); 1.3460 (7.8); 1.3318 (16.0); 1.3177 (7.7); −0.0002 (2.0)
1-122: ¹H-NMR(300.2 MHz, d₆-DMSO):
δ = 7.6263 (7.0); 7.6208 (8.0); 7.6041 (7.8); 7.5988 (15.4); 7.5937 (10.2); 7.5773 (9.0); 7.5715 (9.1);
7.4939 (6.3); 7.4883 (6.7); 7.4705 (6.9); 7.4659 (15.0); 7.4608 (10.0); 7.4430 (11.6); 7.4373 (9.5);
7.3878 (12.6); 7.3827 (12.0); 7.3606 (15.5); 7.3553 (16.0); 7.3332 (6.0); 7.3278 (6.2); 4.2841 (0.3);
4.2288 (0.3); 4.1828 (0.3); 4.0782 (0.4); 4.0617 (0.7); 4.0385 (0.8); 4.0004 (0.5); 3.9889 (0.5); 3.8676
(0.7); 3.8480 (0.7); 3.7660 (1.0); 3.6961 (1.1); 3.6479 (1.4); 3.4652 (2.5); 3.4056 (2.7); 2.8887 (0.6);
2.8098 (0.5); 2.7496 (0.7); 2.7372 (0.6); 2.6482 (1.0); 2.5887 (0.8); 2.5352 (22.4); 2.5292 (46.8);
2.5231 (64.1); 2.5170 (45.9); 2.5109 (21.2); 2.4323 (155.0); 2.3656 (0.8); 2.2932 (0.4); 2.2126 (0.9);
2.0098 (2.0); 1.9302 (3.7); 1.2192 (0.6); 1.1957 (1.1); 1.1719 (0.5); 0.0312 (1.5); 0.0204 (41.7);
0.0095 (1.4)
1-123: ¹H-NMR(300.2 MHz, d₆-DMSO):
δ = 8.0097 (16.0); 7.9655 (0.4); 7.5896 (2.0); 7.5839 (2.2); 7.5674 (2.2); 7.5622 (4.0); 7.5570 (2.9);
7.5410 (2.5); 7.5349 (2.6); 7.4546 (1.7); 7.4489 (1.8); 7.4316 (1.8); 7.4268 (4.3); 7.4214 (2.9); 7.4042
(3.6); 7.3981 (2.8); 7.3687 (3.9); 7.3642 (3.6); 7.3419 (4.2); 7.3370 (4.5); 7.3147 (1.6); 7.3096 (1.7);
3.3531 (2.9); 2.6342 (42.4); 2.5345 (5.6); 2.5285 (12.2); 2.5224 (16.9); 2.5163 (12.2); 2.5103 (5.7);
2.2979 (0.5); 2.2918 (0.5); 2.0090 (1.3); 1.2179 (0.4); 1.1942 (0.7); 1.1704 (0.3); 0.0191 (8.3)
1-124: ¹H-NMR(300.1 MHz, d₆-DMSO):
δ = 8.3018 (6.7); 7.6593 (0.5); 7.6329 (1.5); 7.6066 (1.2); 7.5224 (1.4); 7.4929 (2.4); 7.4756 (1.3);
7.4722 (1.3); 7.4453 (0.9); 7.4418 (0.8); 7.2608 (1.1); 7.0752 (2.3); 6.8897 (1.1); 3.9259 (16.0);
3.3292 (2.6); 2.5084 (2.8); 2.5026 (3.7); 2.4968 (2.6); −0.0005 (2.7)
1-125: ¹H-NMR(400.2 MHz, d₆-DMSO):
δ = 14.0741 (0.4); 7.9771 (5.9); 7.7099 (0.6); 7.6902 (1.7); 7.6704 (1.4); 7.6376 (1.7); 7.6175 (1.0);
7.5995 (2.1); 7.5297 (1.2); 7.5091 (0.9); 3.3301 (0.6); 2.6225 (16.0); 2.5099 (6.7); 2.5056 (14.0);
2.5011 (19.1); 2.4966 (13.7); 2.4923 (6.5); 0.0071 (0.6); −0.0011 (17.7); −0.0094 (0.7)
1-126: ¹H-NMR(400.1 MHz, d₆-DMSO):
δ = 8.0394 (5.5); 7.7256 (0.6); 7.7063 (1.9); 7.6866 (1.6); 7.6542 (2.3); 7.6331 (3.8); 7.5609 (1.6);
7.5403 (1.4); 3.9145 (16.0); 3.3269 (11.0); 2.6442 (15.2); 2.5097 (1.8)
1-127: ¹H-NMR(300.2 MHz, d₆-DMSO):
δ = 8.3829 (16.0); 7.7559 (0.9); 7.7302 (3.0); 7.7046 (6.9); 7.6890 (4.6); 7.6636 (1.2); 7.6081 (2.8);
7.6012 (1.6); 7.5825 (1.5); 3.6424 (0.4); 3.6205 (0.5); 3.5991 (0.5); 3.3722 (3.1); 2.5345 (3.4); 2.5285
(7.2); 2.5224 (9.8); 2.5164 (7.0); 2.5104 (3.2); 2.0087 (0.7); 1.9291 (0.4); 1.3749 (1.9); 1.1939 (0.4);
0.0188 (7.1)
1-128: ¹H-NMR(300.2 MHz, CDCl3):
δ = 7.5864 (0.9); 7.5640 (3.0); 7.5176 (1.3); 7.4753 (0.6); 7.4662 (1.0); 7.4588 (0.6); 7.4542 (0.3);
7.4510 (0.3); 7.4447 (0.6); 7.4366 (0.3); 7.2983 (7.8); 4.0660 (0.4); 4.0444 (15.4); 3.6947 (1.7);
3.6726 (4.0); 3.6510 (2.0); 3.3667 (16.0); 3.1857 (1.9); 3.1640 (3.7); 3.1420 (1.6); 1.5842 (6.0);
0.0375 (8.1)
1-129: ¹H-NMR(400.1 MHz, d₆-DMSO):
δ = 9.2191 (15.2); 9.2072 (15.9); 8.0823 (15.8); 8.0704 (15.6); 7.7415 (2.8); 7.7211 (8.1); 7.7111 (2.0);
7.7009 (7.4); 7.6691 (16.0); 7.6633 (13.8); 7.5863 (6.9); 7.5666 (5.4); 3.5012 (0.4); 3.3202 (3.0);
3.1349 (0.4); 2.5131 (12.7); 2.5088 (16.3); 2.5046 (12.1); 1.9947 (0.8); 1.1820 (0.4)
1-130: ¹H-NMR(300.2 MHz, CDCl3):
δ = 7.9303 (10.8); 7.4583 (0.9); 7.4525 (1.9); 7.4489 (1.8); 7.4421 (2.6); 7.4358 (4.6); 7.4289 (5.6);
7.3628 (2.7); 7.3513 (0.3); 7.3462 (0.3); 7.3356 (4.3); 7.3276 (0.6); 7.3158 (0.6); 7.3075 (2.3); 7.2983
(4.5); 7.2274 (2.0); 7.2237 (2.2); 7.2199 (2.1); 7.2163 (1.8); 7.2002 (1.3); 7.1960 (1.5); 7.1933 (1.4);
7.1892 (1.1); 4.5332 (2.4); 4.5094 (7.5); 4.4856 (7.6); 4.4618 (2.5); 1.6025 (5.0); 1.4783 (7.9); 1.4546
(16.0); 1.4307 (7.6); 0.0365 (4.5)

TABLE 5
Compounds according to formula (2)
(2)

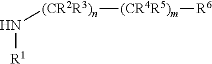

| Ex N^{o} | R¹ | 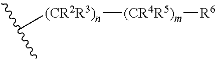 | LogP |
|---|---|---|---|
| 2-01 | H | 2-(4-ethynyl-2-methylphenyl)-2,2-difluoroethyl | 0.93^{[a]} |
| 2-02 | H | 2-(4-cyclopropyl-2-methylphenyl)-2,2-difluoroethyl | 1.30^{[a]} |
| 2-03 | H | 2,2-difluoro-2-(2-fluoro-4,6-dimethylphenyl)ethyl | 0.95^{[a]} |
| 2-04 | H | 2-(3-bromo-2-chlorophenyl)-2,2-difluoroethyl | 0.87^{[a]} |
| 2-05 | H | rac-2-fluoro-2-(4-iodophenyl)ethyl | 0.73^{[a]} |
| 2-06 | H | rac-2-[4-(difluoromethyl)-2-methylphenyl]-2-fluoroethyl | 0.69^{[a]} |
| 2-07 | H | rac-2-(2-chloro-4-cyclopropylphenyl)-2-fluoroethyl | 1.15^{[a]} |

TABLE 6
2-01: ¹H-NMR(300.2 MHz, CDCl3):
δ = 7.8030 (0.4); 7.7768 (0.5); 7.7464 (3.9); 7.7421 (5.2); 7.7370 (2.7); 7.7264 (2.0); 7.7195 (6.8);
7.7142 (6.0); 7.7065 (4.0); 7.7022 (5.3); 7.6971 (2.7); 7.6865 (2.2); 7.6795 (6.7); 7.6744 (5.6); 7.6440
(0.7); 7.6163 (1.6); 7.6112 (1.8); 7.6064 (1.1); 7.6012 (1.2); 7.5922 (3.8); 7.5867 (3.8); 7.5783 (1.6);
7.5725 (2.4); 7.5674 (4.6); 7.5622 (4.1); 7.5570 (1.9); 7.5307 (5.6); 7.5262 (4.0); 7.5210 (5.6); 7.5166
(3.0); 7.5109 (4.5); 7.5058 (6.5); 7.5009 (5.6); 7.4961 (6.3); 7.4906 (2.4); 7.4828 (3.1); 7.4779 (2.8);
7.4729 (3.4); 7.4676 (4.1); 7.4517 (1.7); 7.4385 (8.2); 7.4101 (5.7); 7.3977 (6.4); 7.3340 (1.0); 7.2984
(53.6); 6.9475 (0.5); 5.3375 (1.3); 4.1947 (0.5); 4.1709 (1.5); 4.1471 (1.5); 4.1234 (0.6); 4.1024 (0.4);
3.2771 (5.8); 3.2275 (11.6); 3.2148 (1.2); 3.1780 (6.0); 3.1637 (1.0); 3.1478 (11.9); 2.5255 (0.6);
2.4672 (9.4); 2.4593 (16.0); 2.4514 (9.1); 2.3287 (0.4); 2.2570 (0.4); 2.2439 (0.4); 2.0835 (8.2); 2.0459
(0.4); 2.0360 (0.4); 2.0194 (0.3); 1.6972 (0.3); 1.6708 (0.5); 1.6487 (0.6); 1.6194 (0.7); 1.4966 (2.3);
1.3809 (0.9); 1.3500 (1.0); 1.3206 (2.8); 1.2968 (5.1); 1.2730 (2.2); 1.0369 (0.4); 0.9977 (0.4); 0.9723
(0.7); 0.9482 (0.4); 0.9361 (0.5); 0.9175 (0.5); 0.8925 (0.3); 0.3172 (0.6); 0.3008 (0.6); 0.2947 (0.5);
0.2843 (5.5); 0.2768 (3.1); 0.2705 (7.3); 0.2562 (1.6); 0.2532 (1.6); 0.2469 (4.0); 0.2365 (1.5); 0.2088
(1.3); 0.2037 (1.4); 0.1967 (3.8); 0.1890 (2.3); 0.1602 (1.0); 0.1550 (1.0); 0.1494 (2.4); 0.1441 (3.8);
0.1203 (1.3); 0.1063 (3.2); 0.0880 (0.5); 0.0728 (0.6); 0.0618 (0.4); 0.0474 (2.0); 0.0366 (54.6); 0.0257
(2.6); 0.0155 (1.0); −0.0026 (0.4); −0.0165 (0.7); −0.1616 (0.7)
2-02: ¹H-NMR(400.1 MHz, d₆-DMSO):
δ = 7.5958 (0.3); 7.5766 (0.6); 7.5553 (0.4); 7.2981 (4.4); 7.2781 (5.2); 7.2108 (0.4); 7.1933 (0.4);
7.1631 (0.3); 7.1093 (0.4); 7.0992 (0.4); 7.0394 (0.7); 6.9771 (7.1); 6.9486 (4.1); 6.9071 (1.2); 6.8860
(0.7); 6.7878 (0.8); 6.7697 (0.6); 6.5393 (2.5); 6.4871 (0.8); 6.3004 (2.7); 3.3329 (60.7); 3.2642 (0.6);
3.2415 (0.4); 3.2363 (0.4); 3.2181 (0.4); 3.1900 (0.4); 3.1606 (3.5); 3.1221 (7.1); 3.0833 (3.9); 3.0519
(0.9); 2.9975 (0.6); 2.9711 (7.2); 2.9126 (0.6); 2.7148 (0.4); 2.5111 (35.1); 2.5070 (29.0); 2.3879 (1.7);
2.3544 (16.0); 2.2861 (1.3); 2.2478 (1.9); 2.2119 (0.7); 2.1730 (0.8); 2.1543 (0.7); 2.1033 (0.4); 1.9384
(1.3); 1.9258 (2.3); 1.9175 (2.9); 1.9051 (4.3); 1.8929 (3.6); 1.8844 (3.5); 1.8716 (2.6); 1.8272 (1.1);
1.3889 (0.5); 1.3674 (0.3); 1.3507 (0.6); 1.1684 (8.5); 1.1354 (8.8); 0.9882 (2.6); 0.9771 (6.3); 0.9717
(7.2); 0.9615 (5.4); 0.9564 (7.6); 0.9509 (7.7); 0.9410 (4.5); 0.7405 (0.4); 0.7160 (2.5); 0.7053 (6.6);
0.7007 (7.2); 0.6932 (7.4); 0.6882 (8.3); 0.6772 (4.8); 0.3232 (0.4)
2-03: ¹H-NMR(400.1 MHz, d₆-DMSO):
δ = 6.9629 (1.9); 6.9337 (5.8); 3.3337 (6.4); 3.1780 (2.3); 3.1398 (4.7); 3.1015 (2.5); 2.5152 (3.4);
2.5111 (4.7); 2.5070 (3.7); 2.4123 (4.6); 2.4016 (9.5); 2.3907 (5.4); 2.2867 (16.0); 1.6930 (4.1)
2-04: ¹H-NMR(400.1 MHz, d₆-DMSO):
δ = 7.9521 (10.7); 7.9324 (11.5); 7.7005 (0.4); 7.6529 (10.3); 7.6502 (10.7); 7.6332 (12.7); 7.6305
(12.6); 7.4291 (9.2); 7.4092 (16.0); 7.3894 (7.6); 7.2119 (0.4); 3.3535 (15.6); 3.3158 (31.4); 3.2780
(16.0); 3.1623 (0.4); 3.1315 (0.4); 2.5152 (2.9); 2.5112 (3.9); 2.5071 (3.1); 1.6878 (10.2); 1.3625 (0.4)
2-05: ¹H-NMR(400.0 MHz, d₆-DMSO):
δ = 8.3740 (0.4); 8.3578 (0.4); 8.3255 (1.6); 8.2699 (6.4); 8.1811 (0.3); 7.9546 (0.4); 7.8911 (1.0);
7.8596 (15.1); 7.8396 (16.0); 7.7850 (0.3); 7.7775 (0.4); 7.7687 (0.4); 7.7138 (6.1); 7.6931 (6.5);
7.3163 (0.5); 7.2824 (13.4); 7.2625 (12.3); 7.1511 (0.4); 7.1091 (5.9); 7.0885 (5.4); 5.8556 (2.1);
5.8454 (2.4); 5.8359 (2.0); 5.8256 (2.0); 5.7335 (2.0); 5.7264 (2.3); 5.7103 (2.2); 5.7041 (2.1); 3.8271
(1.2); 3.5626 (0.4); 3.5394 (0.4); 3.4503 (0.6); 3.3398 (1168.7); 3.3377 (1019.1); 3.2838 (3.0); 3.2493
(1.2); 3.0294 (1.6); 3.0023 (1.9); 2.8456 (3.0); 2.8245 (3.4); 2.8067 (2.0); 2.7189 (0.6); 2.6835 (3.2);
2.6790 (4.5); 2.6745 (3.4); 2.6500 (1.6); 2.5491 (163.8); 2.5323 (9.4); 2.5274 (14.4); 2.5188 (278.8);
2.5144 (597.6); 2.5099 (808.1); 2.5054 (583.3); 2.5010 (282.0); 2.3756 (0.9); 2.3411 (3.4); 2.3367
(4.7); 2.3320 (3.5); 2.3274 (1.8); 2.3072 (0.4); 2.0818 (0.4); 2.0548 (0.3); 0.0075 (1.6)
2-06: ¹H-NMR(400.1 MHz, d₆-DMSO):
δ = 8.7157 (5.6); 7.5744 (8.5); 7.5544 (14.3); 7.5024 (11.2); 7.4819 (7.3); 7.4619 (16.0); 7.1776 (6.1);
7.0381 (13.0); 6.8987 (6.4); 6.2790 (3.0); 6.2725 (3.4); 6.2572 (3.1); 6.2513 (3.1); 6.1552 (3.8); 6.1330
(3.8); 3.3496 (2.4); 3.3267 (1.4); 3.3133 (5.4); 3.2913 (10.4); 3.2842 (8.4); 3.2736 (4.7); 3.2492 (4.6);
3.2000 (5.0); 3.1964 (4.9); 3.1650 (2.6); 2.5650 (0.4); 2.5096 (4.7); 2.4076 (64.5); 2.2464 (0.4); 1.9880
(0.6); 1.1742 (0.3)
2-07: ¹H-NMR(400.1 MHz, d₆-DMSO):
δ = 8.6578 (14.7); 7.4994 (0.5); 7.4747 (10.8); 7.4544 (12.1); 7.2592 (16.0); 7.1740 (8.8); 7.1539 (7.7);
6.2003 (3.4); 6.1803 (3.3); 6.0806 (3.4); 6.0599 (3.4); 3.4325 (1.7); 3.3987 (5.2); 3.3735 (3.7); 3.3372
(1.9); 3.2913 (2.9); 3.2565 (1.8); 3.2017 (2.7); 3.1666 (1.9); 2.9854 (0.7); 2.5097 (7.6); 2.0180 (1.5);
2.0054 (3.2); 1.9967 (3.9); 1.9848 (6.1); 1.9728 (4.0); 1.9641 (3.4); 1.9514 (1.8); 1.2461 (0.5); 1.0946
(0.4); 1.0683 (0.3); 1.0499 (0.7); 1.0313 (3.8); 1.0200 (11.0); 1.0149 (12.0); 0.9993 (11.3); 0.9945
(10.9); 0.9840 (4.3); 0.9670 (0.9); 0.9461 (0.7); 0.8630 (0.6); 0.8044 (0.6); 0.7912 (0.7); 0.7661 (4.7);
0.7550 (13.9); 0.7430 (12.7); 0.7390 (13.2); 0.7272 (3.6); 0.7031 (0.6); 0.6918 (0.7); 0.6806 (0.5)

TABLE 7
Compounds according to formula (3)
(3)

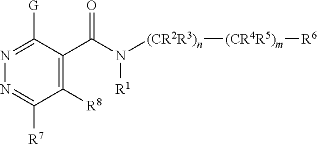

| Ex N^{o} | R¹ | R⁷ | R⁸ | G | 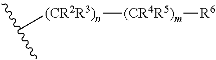 | LogP |
|---|---|---|---|---|---|---|
| 3-01 | H | Cl | H | Cl | 2-(2,4-dimethylphenyl)ethyl | 3.02^{[a]} |
| 3-02 | H | Cl | H | Cl | rac-2-(2,4-dichlorophenyl)-2-fluoroethyl | 3.02^{[a]} |
| 3-03 | H | Cl | H | Cl | 2-(2,4-dimethylphenyl)-2,2-difluoroethyl | 3.19^{[a]} |
| 3-04 | H | methyl | H | Cl | 2-(4-bromo-2-chlorophenyl)-2,2-difluoroethyl | 2.76^{[a]} |
| 3-05 | H | Cl | H | Cl | 2-(4-chlorophenyl)-2,2-difluoroethyl | 2.98^{[a]} |
| 3-06 | H | methyl | H | Cl | 2-(2,4-dimethylphenyl)-2,2-difluoroethyl | 3.20^{[a]} |
| 3-07 | H | Cl | H | Cl | 2-(2,4-dichlorophenyl)ethyl | 3.15^{[a]} |
| 3-08 | H | Cl | H | Cl | rac-2-(4-bromo-2-chlorophenyl)-2-fluoroethyl | 3.27^{[a]} |
| 3-09 | H | Cl | H | Cl | 2-(2,4-dichlorophenyl)-2,2-difluoroethyl | 3.27^{[a]} |
| 3-10 | H | Cl | H | Cl | 2-(4-bromo-2-chlorophenyl)-2,2-difluoroethyl | 3.29^{[a]}; |
| | | | | | | 3.24^{[b]} |
| 3-11 | H | Cl | H | Cl | 2-(4-bromo-2-methylphenyl)-2,2-difluoroethyl | 3.39^{[a]} |
| 3-12 | H | Cl | H | Cl | rac-7-bromo-1,2,3,4-tetrahydronaphthalen-1-yl | 3.29^{[a]} |
| 3-13 | H | Cl | H | Cl | rac-6-bromo-1,2,3,4-tetrahydronaphthalen-1-yl | 3.37^{[a]} |
| 3-14 | H | Cl | H | Cl | rac-5-bromoindan-1-yl | 3.11^{[a]} |
| 3-15 | H | Cl | H | Cl | rac-2-methyl-4,5,6,7-tetrahydro-1-benzothiophen-7- | 2.98^{[a]} |
| | | | | | yl | |
| 3-16 | H | Cl | H | Cl | rac-4,5,6,7-tetrahydro-l-benzothiophen-7-yl | 2.60^{[a]} |
| 3-17 | H | Cl | H | Cl | rac-2-chloro-4,5,6,7-tetrahydro-1-benzothiophen-7- | 3.21^{[a]} |
| | | | | | yl | |
| 3-18 | H | Cl | H | Cl | rac-1-(1-methyl-1H-indol-3-yl)ethyl | 2.71^{[a]} |
| 3-19 | H | Cl | methyl | Cl | 2-(2,4-dimethylphenyl)-2,2-difluoroethyl | 3.31^{[a]} |
| 3-20 | H | Cl | methyl | Cl | rac-2-(2,4-dichlorophenyl)-2-fluoroethyl | 3.34^{[a]} |
| 3-21 | H | Cl | methyl | Cl | rac-2-(4-bromo-2-chlorophenyl)-2-fluoroethyl | 3.43^{[a]} |
| 3-22 | H | Cl | methyl | Cl | rac-2-(2,4-dimethylphenyl)-2-fluoroethyl | 3.19^{[a]} |
| 3-23 | H | Cl | methyl | Cl | rac-2-(2-chloro-4-methylphenyl)-2-fluoroethyl | 3.22^{[a]} |
| 3-24 | H | Cl | methyl | Cl | rac-2-(2-chloro-4-cyclopropylphenyl)-2-fluoroethyl | 3.56^{[a]} |
| 3-25 | H | Cl | methyl | Cl | 2-(4-cyclopropyl-2-methylphenyl)-2,2-difluoroethyl | 3.69^{[a]} |
| 3-26 | H | Cl | methyl | Cl | 2-(4-bromo-2-chlorophenyl)-2,2-difluoroethyl | 3.56^{[a]} |
| 3-27 | H | Cl | methyl | Cl | 2-(2-chloro-4-methylphenyl)-2,2-difluoroethyl | 3.31^{[a]} |
| 3-28 | H | Cl | methyl | Cl | 2-(4-bromo-2-methylphenyl)-2,2-difluoroethyl | 3.60^{[a]} |

TABLE 8
3-01: ¹H-NMR(300.2 MHz, CDCl3):
δ = 7.8392 (8.7); 7.2985 (18.2); 7.0958 (1.6); 7.0704 (3.5); 7.0566 (2.8); 7.0297 (2.0); 7.0038 (0.9);
6.5514 (0.6); 3.7935 (1.5); 3.7700 (3.5); 3.7504 (3.5); 3.7270 (1.7); 3.0051 (2.5); 2.9816 (4.7); 2.9581
(2.2); 2.3972 (0.4); 2.3675 (16.0); 2.3391 (14.3); 2.0969 (0.3); 1.5817 (9.8); 0.0494 (0.8); 0.0384 (24.0);
0.0275 (0.9)
3-02: ¹H-NMR(300.2 MHz, d₆-DMSO):
δ = 14.0362 (0.6); 9.7192 (0.4); 9.2918 (1.2); 9.2719 (2.4); 9.2521 (1.2); 8.1784 (16.0); 8.0140 (2.6);
7.7484 (3.4); 7.7441 (4.2); 7.7392 (3.4); 7.7259 (0.9); 7.6417 (2.9); 7.6271 (0.7); 7.6138 (7.6); 7.5868
(4.8); 7.5802 (4.3); 7.5679 (1.7); 7.5587 (2.7); 7.5523 (2.5); 6.0846 (1.0); 6.0707 (1.2); 6.0639 (1.4);
6.0503 (1.0); 5.9294 (1.0); 5.9110 (1.6); 5.8959 (1.0); 5.7767 (0.5); 3.9096 (0.4); 3.8943 (1.2); 3.8818
(1.7); 3.8643 (2.4); 3.8439 (1.2); 3.8091 (1.8); 3.7884 (2.4); 3.7760 (1.2); 3.7676 (1.1); 3.3876 (4.3);
3.2189 (11.8); 3.0969 (1.8); 2.6491 (17.7); 2.5341 (6.9); 2.5282 (14.5); 2.5221 (19.8); 2.5160 (14.4);
2.5101 (6.8); 1.1264 (4.7); 0.0311 (0.8); 0.0202 (23.4); 0.0093 (0.9)
3-03: ¹H-NMR(400.1 MHz, d₆-DMSO):
δ = 9.3646 (1.1); 9.3493 (2.3); 9.3339 (1.2); 8.0687 (11.4); 7.3925 (3.3); 7.3729 (3.9); 7.1436 (4.8);
7.1160 (2.2); 4.1022 (1.3); 4.0866 (1.3); 4.0640 (2.8); 4.0485 (2.8); 4.0259 (1.5); 4.0103 (1.4); 3.3336
(11.5); 2.5137 (4.4); 2.5095 (5.9); 2.5053 (4.5); 2.4411 (11.5); 2.3120 (16.0); 2.0831 (2.3)
3-04: ¹H-NMR(300.2 MHz, d₆-DMSO):
δ = 9.3209 (1.6); 9.3010 (3.3); 9.2809 (1.6); 7.9515 (5.8); 7.9458 (6.2); 7.7622 (3.0); 7.7561 (2.8);
7.7341 (4.4); 7.7280 (4.4); 7.6322 (16.0); 7.6252 (9.4); 7.5966 (5.6); 4.2852 (1.8); 4.2649 (1.8); 4.2381
(3.8); 4.2176 (3.7); 4.1907 (2.0); 4.1702 (1.8); 3.3484 (16.0); 2.6602 (42.2); 2.5337 (2.1); 2.5279 (4.4);
2.5219 (5.9); 2.5159 (4.4); 2.5102 (2.1); 0.0180 (5.3)
3-05: ¹H-NMR(300.2 MHz, d₆-DMSO):
δ = 9.3415 (1.2); 9.3208 (2.5); 9.3004 (1.3); 8.2438 (0.5); 8.1509 (16.0); 8.1388 (0.4); 8.1319 (0.4);
7.6786 (2.5); 7.6704 (1.3); 7.6486 (13.5); 7.6346 (13.0); 7.6140 (1.8); 7.6046 (3.0); 7.5778 (0.4);
7.5674 (0.4); 4.1703 (1.6); 4.1494 (1.6); 4.1223 (3.5); 4.1014 (3.4); 4.0742 (1.8); 4.0534 (1.7); 4.0403
(0.3); 3.3482 (18.7); 3.0439 (0.4); 2.8843 (0.5); 2.5370 (2.5); 2.5311 (5.2); 2.5250 (7.1); 2.5190 (5.1);
2.5131 (2.5); 2.0120 (0.5); 0.0328 (0.5); 0.0220 (12.0); 0.0111 (0.4)
3-06: ¹H-NMR(300.2 MHz, CDCl3):
δ = 7.6453 (4.7); 7.4228 (1.4); 7.3969 (1.7); 7.2975 (6.1); 7.1085 (3.0); 7.0797 (1.0); 7.0306 (0.6);
5.3357 (0.8); 4.2579 (1.0); 4.2376 (1.0); 4.2087 (2.1); 4.1884 (2.0); 4.1594 (1.1); 4.1391 (1.1); 2.7841
(16.0); 2.7727 (0.9); 2.5340 (3.0); 2.5269 (5.6); 2.5195 (3.1); 2.3770 (7.6); 2.3307 (0.4); 2.0425 (0.5);
1.6317 (1.7); 0.0352 (5.8)
3-07: ¹H-NMR(300.2 MHz, CDCl3):
δ = 8.2560 (2.6); 7.9964 (3.1); 7.8594 (16.0); 7.6443 (0.4); 7.5511 (0.8); 7.5371 (0.6); 7.4529 (5.2);
7.4326 (4.4); 7.4261 (4.6); 7.3250 (0.4); 7.2984 (57.6); 7.2891 (1.5); 7.2665 (8.8); 7.2612 (15.2);
7.2536 (2.4); 7.2465 (1.7); 7.2333 (3.0); 7.2289 (4.0); 7.2261 (4.2); 7.2191 (3.7); 7.1888 (5.0); 7.1615
(2.0); 6.6000 (0.9); 3.8494 (2.7); 3.8263 (6.4); 3.8061 (6.5); 3.7831 (3.2); 3.7566 (1.1); 3.7364 (1.0);
3.7125 (0.5); 3.6463 (1.6); 3.6235 (4.0); 3.6013 (3.8); 3.5779 (1.8); 3.1517 (5.2); 3.1286 (10.1); 3.1054
(4.7); 3.0965 (1.3); 3.0726 (1.6); 3.0490 (0.9); 3.0318 (3.2); 3.0082 (5.4); 2.9847 (2.6); 2.0846 (1.5);
1.3216 (0.4); 1.2976 (1.2); 1.2923 (1.1); 1.2741 (0.4); 0.0481 (2.3); 0.0374 (65.9); 0.0264 (2.6)
3-08: ¹H-NMR(300.2 MHz, d6-DMSO):
δ = 9.2939 (1.6); 9.2748 (3.0); 9.2561 (1.5); 8.1801 (13.0); 7.8553 (5.3); 7.7168 (2.8); 7.7108 (2.5);
7.6891 (3.9); 7.6829 (3.6); 7.5608 (6.2); 7.5329 (4.5); 6.0683 (1.0); 6.0552 (1.4); 6.0482 (1.5); 6.0348
(1.1); 5.9136 (1.0); 5.8954 (1.7); 5.8808 (1.1); 3.8903 (1.2); 3.8784 (1.9); 3.8600 (2.6); 3.8401 (1.2);
3.8045 (2.0); 3.7841 (2.7); 3.7634 (1.2); 3.3473 (16.0); 3.2176 (0.8); 2.6477 (1.2); 2.5274 (8.7); 2.5216
(11.1); 2.5159 (8.3); 0.0188 (6.4)
3-09: ¹H-NMR(300.2 MHz, CDCl3):
δ = 7.8349 (16.0); 7.8241 (0.4); 7.6371 (4.8); 7.6087 (6.0); 7.5614 (4.1); 7.5580 (4.1); 7.5550 (4.3);
7.5164 (0.4); 7.4140 (3.2); 7.4073 (3.0); 7.3858 (2.5); 7.3790 (2.3); 7.2986 (19.4); 6.9588 (1.4); 6.9477
(1.0); 5.3378 (0.8); 4.4506 (2.8); 4.4297 (2.8); 4.4020 (6.0); 4.3811 (5.7); 4.3534 (3.0); 4.3325 (2.9);
1.5991 (7.5); 1.2912 (0.4); 0.1061 (0.8); 0.0471 (0.9); 0.0363 (19.1); 0.0254 (0.8)
3-10: ¹H-NMR(400.0 MHz, d₆-DMSO):
δ = 9.3457 (1.7); 9.3301 (3.4); 9.3146 (1.7); 8.0939 (16.0); 8.0754 (0.6); 7.9351 (6.0); 7.9314 (6.4);
7.7363 (2.8); 7.7320 (2.8); 7.7153 (4.0); 7.7108 (4.1); 7.6115 (7.2); 7.5902 (5.2); 4.2648 (1.8); 4.2491
(1.9); 4.2294 (4.1); 4.2136 (3.9); 4.1938 (2.1); 4.1780 (1.9); 4.0384 (0.5); 4.0207 (0.5); 3.3219 (55.9);
2.6714 (0.4); 2.6670 (0.3); 2.5067 (56.1); 2.5024 (73.3); 2.4980 (54.9); 2.3335 (0.3); 2.3290 (0.4);
1.9891 (2.0); 1.1931 (0.5); 1.1754 (1.0); 1.1576 (0.5); 0.0076 (1.7); −0.0003 (37.2)
3-11: ¹H-NMR(300.2 MHz, CDCl3):
δ = 7.8353 (5.8); 7.5224 (0.5); 7.4827 (1.8); 7.4677 (0.8); 7.4387 (1.4); 7.4069 (2.7); 7.3790 (1.0);
7.3017 (13.9); 6.9504 (0.5); 6.9439 (0.5); 6.9269 (0.3); 4.2575 (1.0); 4.2368 (1.0); 4.2084 (2.0); 4.1877
(2.0); 4.1592 (1.0); 4.1386 (1.0); 3.5389 (0.8); 3.5206 (0.8); 2.5650 (2.9); 2.5579 (5.5); 2.5505 (3.0);
2.3078 (0.5); 2.0492 (10.2); 1.6024 (16.0); 1.2986 (0.3); 0.0500 (0.3); 0.0391 (12.0); 0.0281 (0.4)
3-12: ¹H-NMR(300.2 MHz, CDCl3):
δ = 7.8705 (16.0); 7.4861 (4.7); 7.4801 (5.1); 7.3663 (2.8); 7.3595 (2.6); 7.3389 (3.3); 7.3322 (3.1);
7.2984 (10.6); 7.0497 (4.7); 7.0223 (4.0); 6.8759 (1.4); 6.8478 (1.5); 5.3975 (0.7); 5.3811 (1.7); 5.3536
(1.8); 5.3339 (0.9); 2.8680 (0.4); 2.8465 (0.3); 2.8312 (1.4); 2.8123 (3.9); 2.7917 (3.6); 2.7716 (1.5);
2.7353 (0.4); 2.2347 (0.5); 2.2171 (0.9); 2.1932 (1.3); 2.1769 (1.4); 2.1636 (1.6); 2.1460 (1.2); 2.1297
(0.4); 2.0441 (0.6); 2.0310 (0.7); 2.0212 (1.2); 2.0091 (1.5); 2.0000 (1.3); 1.9872 (1.2); 1.9797 (1.6);
1.9646 (2.1); 1.9586 (3.1); 1.9442 (3.7); 1.9347 (2.4); 1.9281 (2.7); 1.9127 (2.3); 1.9024 (1.4); 1.8905
(1.1); 1.8771 (0.6); 1.6009 (6.8); 1.2906 (1.7); 0.1064 (2.2); 0.0469 (0.4); 0.0361 (9.6); 0.0251 (0.4)
3-13: ¹H-NMR(300.2 MHz, CDCl3):
δ = 7.8619 (16.0); 7.3655 (1.8); 7.3589 (2.5); 7.3269 (6.7); 7.2984 (10.2); 7.2396 (5.4); 7.2126 (3.5);
6.8370 (1.4); 6.8094 (1.5); 5.3866 (0.8); 5.3694 (1.8); 5.3498 (1.4); 5.3420 (1.7); 5.3232 (0.9); 2.9024
(0.4); 2.8651 (1.6); 2.8465 (3.4); 2.8285 (3.3); 2.8091 (1.5); 2.2283 (0.4); 2.2151 (0.6); 2.2106 (0.6);
2.1970 (0.8); 2.1850 (1.2); 2.1679 (1.4); 2.1535 (1.5); 2.1442 (0.8); 2.1356 (1.3); 2.1186 (0.4); 2.0649
(0.9); 2.0536 (0.8); 2.0403 (1.1); 2.0297 (1.4); 2.0202 (1.2); 2.0094 (1.2); 1.9976 (1.2); 1.9865 (1.0);
1.9773 (1.6); 1.9617 (1.2); 1.9529 (1.5); 1.9423 (2.0); 1.9327 (2.3); 1.9212 (2.2); 1.9123 (2.3); 1.9008
(1.7); 1.8898 (1.6); 1.8711 (0.8); 1.8597 (0.6); 1.8457 (0.3); 1.6012 (7.3); 1.3028 (1.1); 0.9394 (0.4);
0.9179 (1.1); 0.8946 (0.4); 0.0469 (0.4); 0.0361 (10.5); 0.0251 (0.4)
3-14: ¹H-NMR(300.2 MHz, CDCl3):
δ = 7.8823 (16.0); 7.4640 (5.0); 7.4248 (2.5); 7.4222 (2.2); 7.4191 (2.0); 7.3979 (3.3); 7.3952 (3.1);
7.3922 (2.9); 7.2986 (11.2); 7.2748 (4.8); 7.2480 (3.4); 6.8431 (1.3); 6.8171 (1.3); 5.6775 (1.0); 5.6523
(2.5); 5.6271 (2.5); 5.6018 (0.9); 3.1369 (0.5); 3.1219 (0.6); 3.1079 (0.5); 3.0917 (0.7); 3.0826 (1.4);
3.0672 (1.6); 3.0534 (1.6); 3.0368 (2.2); 3.0067 (2.6); 2.9803 (1.8); 2.9522 (0.9); 2.9265 (0.6); 2.7997
(0.9); 2.7845 (0.9); 2.7737 (1.6); 2.7580 (1.8); 2.7476 (1.0); 2.7406 (1.1); 2.7299 (2.0); 2.7146 (1.6);
2.7036 (0.9); 2.6884 (0.7); 2.0872 (0.9); 2.0619 (1.5); 2.0584 (1.2); 2.0431 (1.1); 2.0387 (1.4); 2.0352
(1.5); 2.0177 (1.4); 2.0144 (1.2); 2.0099 (1.1); 1.9946 (1.2); 1.9912 (1.2); 1.9657 (0.7); 1.6038 (3.7);
1.2909 (2.7); 1.2654 (0.3); 0.1066 (0.8); 0.0470 (0.4); 0.0363 (10.1); 0.0255 (0.5)
3-15: ¹H-NMR(300.2 MHz, CDCl3):
δ = 7.8683 (11.0); 7.2985 (6.0); 6.8605 (0.8); 6.8362 (0.8); 6.4732 (3.9); 6.4707 (3.9); 5.3804 (0.5);
5.3649 (1.0); 5.3394 (1.1); 5.3209 (0.5); 4.1560 (0.5); 4.1322 (0.5); 2.6860 (0.4); 2.6699 (0.3); 2.6501
(0.9); 2.6294 (2.3); 2.6044 (1.8); 2.5845 (1.0); 2.5484 (0.4); 2.4601 (16.0); 2.2670 (0.3); 2.2526 (0.5);
2.2358 (0.7); 2.2234 (0.9); 2.2068 (1.0); 2.1926 (0.9); 2.1812 (0.6); 2.1751 (0.8); 2.1669 (0.4); 2.0696
(2.4); 2.0535 (0.4); 2.0418 (0.6); 2.0298 (0.7); 2.0186 (0.9); 2.0111 (0.8); 2.0000 (0.9); 1.9884 (0.6);
1.9717 (0.8); 1.9613 (0.7); 1.9558 (0.6); 1.9396 (0.9); 1.9212 (1.6); 1.9092 (1.4); 1.9005 (1.8); 1.8920
(1.3); 1.8861 (1.5); 1.8805 (1.1); 1.8736 (1.0); 1.8672 (0.9); 1.8548 (0.5); 1.8434 (0.4); 1.6150 (1.8);
1.3429 (0.4); 1.3142 (1.5); 1.3031 (2.5); 1.2908 (2.8); 1.2667 (0.8); 0.9399 (0.9); 0.9181 (2.8); 0.8949
(1.1); 0.1067 (0.7); 0.0362 (5.9)
3-16: ¹H-NMR(300.2 MHz, CDCl3):
δ = 7.8561 (16.0); 7.2984 (7.6); 7.2557 (4.9); 7.2387 (5.2); 6.9473 (1.2); 6.9218 (1.2); 6.8254 (5.8);
6.8084 (5.4); 5.4719 (0.7); 5.4545 (1.5); 5.4286 (1.5); 5.4095 (0.7); 5.3353 (0.6); 4.1750 (0.6); 4.1512
(1.7); 4.1273 (1.8); 4.1036 (0.6); 2.7816 (0.5); 2.7465 (1.3); 2.7267 (3.6); 2.7040 (3.2); 2.6844 (1.2);
2.6723 (0.4); 2.6478 (0.4); 2.3068 (0.5); 2.2911 (0.8); 2.2736 (0.8); 2.2642 (1.3); 2.2476 (1.4); 2.2341
(1.5); 2.2255 (0.6); 2.2167 (1.1); 2.2024 (0.4); 2.0650 (8.4); 2.0492 (1.1); 2.0373 (1.3); 2.0299 (1.2);
2.0182 (1.2); 2.0092 (1.1); 1.9986 (1.0); 1.9905 (1.5); 1.9758 (2.2); 1.9672 (1.6); 1.9589 (2.8); 1.9469
(2.2); 1.9398 (2.7); 1.9240 (2.2); 1.9194 (1.8); 1.9071 (1.1); 1.8875 (0.6); 1.6183 (2.7); 1.3119 (2.5);
1.2882 (4.8); 1.2643 (2.2); 0.9175 (0.9); 0.8941 (0.4); 0.1061 (0.7); 0.0356 (7.4)
3-17: ¹H-NMR(300.2 MHz, CDCl3):
δ = 7.8613 (16.0); 7.2984 (9.2); 6.9882 (1.4); 6.9615 (1.4); 6.6367 (11.6); 5.3565 (0.8); 5.3391 (1.7);
5.3174 (1.6); 5.3124 (1.7); 5.2940 (0.8); 4.1526 (0.5); 4.1288 (0.5); 2.6869 (0.5); 2.6511 (1.4); 2.6318
(3.9); 2.6115 (3.7); 2.5923 (1.4); 2.5553 (0.4); 2.5508 (0.4); 2.2852 (0.5); 2.2700 (0.8); 2.2522 (0.8);
2.2425 (1.4); 2.2255 (1.5); 2.2121 (1.5); 2.1943 (1.1); 2.1804 (0.4); 2.0675 (2.2); 2.0498 (0.6); 2.0381
(0.8); 2.0263 (1.1); 2.0148 (1.4); 2.0072 (1.2); 1.9959 (1.3); 1.9861 (1.1); 1.9678 (1.5); 1.9537 (2.3);
1.9462 (1.8); 1.9380 (2.9); 1.9263 (2.2); 1.9184 (3.0); 1.9033 (2.2); 1.8845 (1.4); 1.8763 (0.9); 1.8645
(0.6); 1.8507 (0.3); 1.6115 (4.1); 1.3428 (0.4); 1.3128 (1.4); 1.3020 (2.3); 1.2894 (2.7); 1.2654 (0.8);
0.9389 (0.8); 0.9172 (2.4); 0.8940 (1.0); 0.1055 (0.8); 0.0460 (0.3); 0.0353 (9.0); 0.0244 (0.4)
3-18: ¹H-NMR(400.1 MHz, CDCl3):
δ = 7.8012 (5.8); 7.6631 (1.8); 7.6432 (2.0); 7.3418 (1.2); 7.3213 (2.5); 7.2905 (1.2); 7.2726 (1.8);
7.2612 (10.2); 7.2548 (1.3); 7.1725 (1.2); 7.1546 (1.8); 7.1368 (0.9); 7.0730 (4.3); 6.6115 (0.6); 6.5943
(0.6); 5.6579 (0.9); 5.6403 (1.3); 5.6226 (0.9); 3.7901 (16.0); 2.9485 (0.6); 2.8693 (0.6); 1.7906 (6.8);
1.7737 (6.9); 1.5703 (10.8); −0.0002 (0.9)
3-19: ¹H-NMR(300.2 MHz, CDCl3):
δ = 7.3834 (1.6); 7.3569 (1.9); 7.2990 (8.6); 7.0838 (2.1); 7.0653 (1.5); 7.0377 (1.2); 4.2746 (0.8);
4.2536 (0.8); 4.2257 (1.7); 4.2047 (1.6); 4.1767 (0.9); 4.1557 (0.8); 2.5232 (5.7); 2.3723 (16.0); 2.3553
(7.8); 1.5980 (7.5); 1.3034 (0.4); 1.2939 (0.4); 0.9199 (0.4); 0.0488 (0.4); 0.0380 (10.8); 0.0271 (0.4)
3-20: ¹H-NMR(300.2 MHz, CDCl3):
δ = 7.4993 (1.6); 7.4707 (4.3); 7.4645 (1.7); 7.3795 (1.7); 7.3727 (1.4); 7.3517 (1.0); 7.3450 (0.9);
7.2986 (12.4); 6.8960 (0.4); 6.8760 (0.8); 6.8564 (0.4); 6.1110 (0.4); 6.1019 (0.5); 6.0864 (0.5); 6.0771
(0.4); 5.9548 (0.4); 5.9456 (0.5); 5.9299 (0.5); 5.9207 (0.4); 4.2477 (0.3); 4.2380 (0.3); 4.1520 (0.3);
3.8943 (0.3); 3.8691 (0.4); 3.8439 (0.5); 3.8199 (0.5); 3.7992 (0.3); 2.4254 (16.0); 2.0431 (0.4); 1.6099
(6.8); 1.2929 (0.5); 0.1064 (0.9); 0.0477 (0.5); 0.0369 (13.2); 0.0292 (0.4); 0.0278 (0.4); 0.0260 (0.5)
3-21: ¹H-NMR(300.2 MHz, CDCl3):
δ = 7.6390 (1.2); 7.6337 (1.9); 7.6289 (1.4); 7.5504 (0.9); 7.5441 (0.8); 7.5224 (1.5); 7.5163 (1.4);
7.4373 (2.2); 7.4096 (1.3); 7.3082 (0.4); 7.2990 (24.2); 6.5330 (0.6); 6.5166 (0.3); 6.0978 (0.4); 6.0891
(0.4); 6.0727 (0.4); 6.0632 (0.4); 5.9415 (0.4); 5.9326 (0.4); 5.9156 (0.4); 5.9069 (0.4); 4.1670 (0.3);
3.8257 (0.5); 3.8071 (0.3); 3.8010 (0.4); 3.5279 (0.4); 2.4213 (16.0); 1.5975 (9.9); 1.2931 (0.7); 0.1071
(1.2); 0.0486 (0.8); 0.0454 (0.4); 0.0378 (27.4); 0.0269 (1.0)
3-22: ¹H-NMR(300.2 MHz, CDCl3):
δ = 7.3597 (0.5); 7.3403 (0.8); 7.3146 (1.9); 7.2990 (3.5); 7.2885 (2.0); 7.0782 (1.2); 7.0508 (1.1);
7.0375 (1.9); 5.9893 (0.4); 5.9802 (0.4); 5.9616 (0.5); 5.9525 (0.4); 5.8305 (0.4); 5.8213 (0.4); 5.8029
(0.5); 5.7938 (0.4); 4.1209 (0.4); 3.7474 (0.4); 3.7317 (0.4); 3.7153 (0.5); 3.7039 (0.3); 3.6865 (0.4);
2.4418 (16.0); 2.4078 (9.5); 2.3448 (8.2); 2.0403 (0.4); 1.6357 (2.8); 0.0383 (3.9)
3-23: ¹H-NMR(300.2 MHz, CDCl3):
δ = 7.4014 (1.7); 7.3751 (2.1); 7.2984 (6.9); 7.2373 (2.0); 7.1469 (1.2); 7.1205 (1.0); 7.0648 (0.4);
7.0446 (0.8); 7.0252 (0.4); 6.1127 (0.4); 6.1029 (0.4); 6.0888 (0.5); 6.0787 (0.4); 5.9568 (0.4); 5.9473
(0.4); 5.9329 (0.5); 5.9230 (0.4); 4.2319 (0.3); 4.2216 (0.3); 4.1401 (0.4); 3.9259 (0.4); 3.9203 (0.3);
3.9016 (0.4); 3.8736 (0.5); 3.8549 (0.5); 3.8309 (0.3); 2.4216 (16.0); 2.3636 (9.2); 2.0419 (0.3); 1.6165
(8.0); 0.1062 (0.8); 0.0380 (3.2); 0.0363 (6.6)
3-24: ¹H-NMR(300.2 MHz, CDCl3):
δ = 7.7793 (0.6); 7.7594 (1.0); 7.7392 (0.6); 7.3541 (2.0); 7.3273 (2.3); 7.2989 (2.1); 7.0556 (2.5);
6.9873 (1.5); 6.9817 (1.3); 6.9604 (1.3); 6.9548 (1.1); 6.0854 (0.4); 6.0752 (0.5); 6.0621 (0.5); 6.0519
(0.4); 5.9299 (0.4); 5.9198 (0.5); 5.9066 (0.5); 5.8964 (0.4); 4.1700 (0.3); 4.0915 (0.3); 3.9478 (0.4);
3.9445 (0.4); 3.9246 (0.3); 3.8951 (0.5); 3.8756 (0.6); 3.8519 (0.3); 2.4191 (16.0); 2.4027 (0.4); 2.0368
(1.0); 1.8954 (0.5); 1.8842 (0.6); 1.8675 (1.1); 1.8558 (0.4); 1.8508 (0.6); 1.8397 (0.6); 1.6884 (0.9);
1.0650 (0.8); 1.0495 (1.8); 1.0430 (2.1); 1.0374 (1.1); 1.0278 (1.1); 1.0212 (1.9); 1.0149 (1.8); 1.0000
(0.9); 0.7232 (0.9); 0.7078 (2.4); 0.7023 (2.0); 0.6913 (2.0); 0.6858 (2.5); 0.6695 (0.7); 0.0350 (2.3)
3-25: ¹H-NMR(300.2 MHz, CDCl3):
δ = 7.6655 (0.6); 7.6449 (1.2); 7.6244 (0.6); 7.3459 (2.0); 7.3189 (2.3); 7.3003 (1.7); 7.2985 (3.1);
6.9288 (2.5); 6.8999 (1.4); 6.8724 (1.2); 4.2575 (0.8); 4.2365 (0.8); 4.2089 (1.6); 4.1880 (1.6); 4.1603
(0.8); 4.1394 (0.8); 2.5073 (6.7); 2.3586 (16.0); 1.9016 (0.6); 1.8902 (0.6); 1.8738 (1.1); 1.8572 (0.7);
1.8459 (0.6); 1.8289 (0.3); 1.6523 (1.6); 1.0535 (0.8); 1.0384 (2.0); 1.0314 (2.3); 1.0164 (1.2); 1.0099
(2.1); 1.0035 (2.0); 0.9887 (0.9); 0.7385 (0.9); 0.7234 (2.6); 0.7179 (2.3); 0.7068 (2.1); 0.7012 (2.6);
0.6849 (0.7); 0.1077 (0.4); 0.0389 (1.8); 0.0371 (3.3)
3-26: ¹H-NMR(300.2 MHz, CDCl3):
δ = 7.7186 (1.5); 7.5576 (4.3); 7.5542 (3.9); 7.2987 (24.7); 6.4612 (0.4); 4.4628 (0.6); 4.4416 (0.5);
4.4132 (1.2); 4.3920 (1.1); 4.3628 (1.0); 4.3424 (0.6); 3.5281 (0.5); 2.4043 (10.2); 1.5963 (16.0);
1.2940 (0.6); 0.1067 (2.8); 0.0482 (1.0); 0.0374 (28.6); 0.0283 (0.9); 0.0266 (1.0)
3-27: ¹H-NMR(300.2 MHz, CDCl3):
δ = 7.9056 (0.5); 7.8848 (1.1); 7.8639 (0.5); 7.4594 (2.1); 7.4326 (2.4); 7.2989 (2.2); 7.2486 (2.2);
7.0700 (1.2); 7.0434 (1.1); 4.4683 (0.8); 4.4471 (0.7); 4.4205 (1.6); 4.3994 (1.6); 4.3728 (0.8); 4.3516
(0.8); 2.3839 (16.0); 2.3346 (8.7); 2.0378 (0.4); 1.6497 (1.9); 0.0354 (2.7)
3-28: ¹H-NMR(300.2 MHz, CDCl3):
δ = 7.4883 (0.7); 7.4398 (0.5); 7.4104 (1.1); 7.3826 (0.4); 7.2989 (18.5); 4.2725 (0.4); 4.2511 (0.3);
4.2226 (0.7); 4.2014 (0.7); 4.1726 (0.4); 4.1518 (0.4); 2.5703 (2.2); 2.5635 (1.2); 2.3771 (6.6); 2.0466
(0.3); 1.5857 (16.0); 1.2928 (0.7); 0.0484 (0.8); 0.0377 (24.8); 0.0268 (1.0)

TABLE 9
Compounds according to formula (4)
(4)

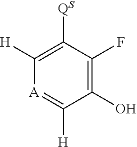

| Ex N^{o} | A | Q^{S} | LogP |
|---|---|---|---|
| 4-01 | CH | prop-l-en-l-yl | 2.33^{[a]} |
| 4-02 | CH | cyclopropyl | 2.12^{[a]} |
| 4-03 | CH | vinyl | 1.96^{[a]} |
| 4-04 | CH | ethynyl | 1.72^{[a]} |
| 4-05 | CH | rac-2,2-difluorocyclopropyl | |
| 4-06 | CH | 1-fluorocyclopropyl | |

TABLE 10
4-01: ¹H-NMR(499.9 MHz, CDCl3):
δ = 7.3302 (0.3); 7.2563 (7.5); 6.9959 (2.3); 6.9937 (2.2); 6.9796 (5.4); 6.9781 (5.6); 6.9641 (3.7);
6.9622 (4.0); 6.9399 (3.1); 6.9294 (2.7); 6.9259 (2.0); 6.9094 (2.9); 6.9062 (3.5); 6.8931 (4.7); 6.8899
(5.3); 6.8767 (2.1); 6.8736 (2.2); 6.8480 (0.8); 6.8409 (3.0); 6.8383 (3.4); 6.8259 (5.3); 6.8183 (1.0);
6.8125 (2.7); 6.5247 (0.7); 6.5216 (0.8); 6.4929 (1.0); 6.4898 (1.1); 6.4244 (3.3); 6.4013 (3.6); 6.3514
(0.4); 6.3382 (1.1); 6.3249 (1.0); 6.3116 (0.4); 6.3064 (0.8); 6.2931 (0.8); 5.9560 (1.3); 5.9418 (3.8);
5.9330 (1.3); 5.9276 (3.9); 5.9188 (3.6); 5.9135 (1.5); 5.9046 (3.5); 5.8904 (1.2); 5.1702 (0.6); 5.1565
(0.6); 5.1063 (0.8); 2.0489 (0.8); 1.9189 (3.6); 1.9158 (3.7); 1.9056 (3.6); 1.9025 (3.7); 1.8255 (9.5);
1.8226 (16.0); 1.8196 (10.8); 1.8113 (9.8); 1.8083 (16.0); 1.8055 (10.6); 1.2596 (0.4); 1.2511 (0.5);
0.0813 (0.7); −0.0002 (9.1)
4-02: ¹H-NMR(300.1 MHz, d₆-DMSO):
δ = 9.6264 (16.0); 6.8628 (2.1); 6.8591 (2.1); 6.8364 (5.2); 6.8326 (5.3); 6.8101 (3.6); 6.8066 (3.8);
6.7434 (3.5); 6.7378 (3.8); 6.7159 (5.1); 6.7104 (5.3); 6.6887 (2.4); 6.6832 (2.3); 6.3737 (2.6); 6.3684
(2.6); 6.3475 (4.7); 6.3262 (2.4); 6.3211 (2.2); 5.7578 (0.4); 4.0415 (0.8); 4.0178 (0.9); 3.3382 (6.7);
2.5154 (2.8); 2.5095 (5.4); 2.5036 (7.2); 2.4976 (4.9); 2.4918 (2.2); 2.0462 (0.7); 2.0289 (1.6); 2.0180
(1.8); 2.0009 (3.3); 1.9896 (5.1); 1.9730 (1.8); 1.9556 (0.9); 1.1988 (1.0); 1.1751 (2.1); 1.1513 (1.0);
0.9636 (2.7); 0.9495 (7.4); 0.9420 (7.8); 0.9356 (3.5); 0.9287 (4.0); 0.9210 (7.8); 0.9136 (7.1); 0.9005
(3.3); 0.8787 (0.4); 0.7131 (0.3); 0.6811 (3.5); 0.6678 (8.1); 0.6606 (8.4); 0.6506 (7.8); 0.6434 (8.0);
0.6289 (2.6); −0.0004 (5.8)
4-03: ¹H-NMR(300.2 MHz, CDCl3):
δ = 7.2988 (8.3); 7.0822 (1.8); 7.0748 (2.4); 7.0563 (7.2); 7.0491 (7.3); 7.0406 (18.4); 7.0294 (8.8);
7.0183 (16.0); 7.0042 (0.7); 6.9921 (5.6); 6.9704 (6.4); 6.9630 (5.7); 6.9437 (7.8); 6.9375 (3.4); 6.9324
(4.6); 6.9257 (7.2); 6.9223 (4.7); 6.9109 (3.1); 6.8885 (6.8); 6.8667 (7.3); 6.8294 (7.6); 5.8978 (11.2);
5.8944 (11.6); 5.8387 (10.0); 5.8353 (10.3); 5.4557 (11.1); 5.4523 (11.2); 5.4184 (10.5); 5.4150 (10.7);
5.3378 (12.9); 5.2491 (9.5); 4.1831 (0.6); 4.1593 (0.6); 2.0946 (2.9); 1.6957 (8.4); 1.3266 (1.2); 1.3201
(1.8); 1.3029 (3.6); 1.2968 (3.9); 1.2790 (1.0); 1.2733 (1.4); 1.2639 (0.5); 0.9451 (0.6); 0.9234 (1.7);
0.9002 (0.7); 0.3136 (0.6); 0.3114 (0.6); 0.1135 (0.5); 0.0418 (9.8); 0.0309 (0.3)
4-04: ¹H-NMR(300.2 MHz, d₆-DMSO):
δ = 10.1443 (10.6); 7.0557 (1.1); 7.0475 (1.7); 7.0294 (5.0); 7.0208 (9.2); 7.0121 (10.7); 6.9957 (16.0);
6.9697 (3.6); 6.9611 (5.2); 6.9532 (4.8); 6.9420 (4.8); 6.9372 (2.6); 6.9281 (4.3); 6.9105 (2.0); 5.7720
(0.5); 4.4390 (15.0); 3.3732 (6.7); 2.5346 (1.0); 2.5286 (2.1); 2.5226 (2.9); 2.5166 (2.1); 2.5107 (1.0);
2.1030 (9.3); 2.0061 (0.8); 1.2540 (0.8); 1.1910 (0.5); 1.0987 (0.3); 1.0754 (0.7); 1.0521 (0.3); 0.8709
(0.6); 0.0130 (3.7)
4-05: ¹H-NMR(300.2 MHz, CDCl3):
δ = 7.2988 (0.5); 7.0418 (0.4); 7.0149 (1.2); 6.9891 (2.4); 6.9810 (1.1); 6.9623 (0.9); 6.9569 (0.9);
6.9354 (0.3); 6.7340 (0.4); 6.7264 (0.4); 6.7100 (0.8); 6.6868 (0.4); 6.6841 (0.4); 5.4977 (1.0); 5.3330
(0.8); 2.8803 (0.3); 2.8674 (0.6); 2.8398 (0.6); 2.8264 (0.4); 2.7988 (0.3); 2.0439 (16.0); 1.9405 (0.4);
1.9265 (0.6); 1.9103 (0.5); 1.9009 (0.6); 1.8842 (0.6); 1.8612 (0.4); 1.8442 (0.4); 1.7154 (0.3); 1.7014
(0.5); 1.6880 (0.7); 1.6738 (0.5); 1.6597 (0.7); 1.6462 (0.6); 0.0359 (0.7)
4-06: ¹H-NMR(300.2 MHz, CDCl3):
δ = 7.2989 (22.6); 7.1680 (0.4); 7.1558 (0.6); 7.1500 (0.9); 7.1325 (1.2); 7.1213 (0.4); 7.1047 (1.8);
7.0896 (1.0); 7.0770 (4.3); 7.0605 (33.6); 7.0549 (23.8); 7.0432 (11.9); 7.0398 (16.0); 7.0347 (9.4);
7.0256 (4.5); 7.0210 (3.8); 7.0125 (2.1); 7.0074 (1.9); 7.0039 (1.9); 5.1920 (11.4); 3.6842 (0.4); 3.3468
(0.4); 2.1527 (0.4); 2.1394 (0.3); 2.1195 (0.3); 2.1161 (0.3); 2.0859 (0.3); 2.0500 (0.4); 1.6703 (0.4);
1.6596 (0.6); 1.6394 (7.8); 1.5230 (3.1); 1.5003 (9.4); 1.4973 (10.4); 1.4743 (4.2); 1.4603 (3.2); 1.4377
(9.4); 1.4345 (10.3); 1.4116 (4.9); 1.3500 (0.5); 1.2497 (0.7); 1.2391 (0.5); 1.2200 (0.8); 1.1889 (4.2);
1.1732 (5.5); 1.1681 (11.0); 1.1612 (12.7); 1.1386 (13.2); 1.1327 (9.8); 1.1110 (3.1); 0.0502 (0.9);
0.0394 (29.9); 0.0285 (1.1)

Biological Data

The advanced fungicidal activity of the active compound combinations according to the invention is evident from the example below. While the individual active compounds exhibit weaknesses with regard to the fungicidal activity, the combinations have an activity, which exceeds a simple addition of activities.

A synergistic effect of fungicides is always present, when the fungicidal activity of the active compound combinations exceeds the total of activities of the active compounds when applied individually. The expected activity for a given combination of two active compounds can be calculated as follows (cf. Colby, S. R., “Calculating Synergistic and Antagonistic Responses of Herbicide Combinations”, Weeds 1967, 15, 20-22):

If
X is the efficacy when active compound A is applied at an application rate of m ppm (or g/ha),
Y is the efficacy when active compound B is applied at an application rate of n ppm (or g/ha),
E is the efficacy when the active compounds A and B are applied at application rates of m and n ppm (or g/ha), respectively, and
   then

$$E = X + Y - \frac{X \cdot Y}{100}$$

The degree of efficacy expressed in % is denoted: 0% means an efficacy, which corresponds to that of the control, while an efficacy of 100% means that no disease is observed.

If the actual fungicidal activity exceeds the calculated value, then the activity of the combination is super-additive, i.e. a synergistic effect exists. In this case, the efficacy, which was actually observed, must be greater than the value for the expected efficacy (E), that was calculated from the abovementioned formula.

A further way of demonstrating a synergistic effect is the method of Tammes (cf. “Isoboles, a graphic representation of synergism in pesticides” in Neth. J. Plant Path., 1964, 70, 73-80).

The invention is illustrated by the following examples. However, the invention is not limited to the examples.

Example: In Vitro-Test with Fungal Microorganisms

Wells of 96-well microtiter plates are filled with 10 μl of a preparation of test compound or compound combination in methanol+emulsifier alkylaryl-polyglycol-ether. Thereafter, the solvent is evaporated in a hood. At the next step, 100 μl of liquid potato dextrose medium is given into each well, that has been amended with an appropriate concentration of spores or mycelium suspension of the test fungus.

With the aid of a photometer, the extinction in all wells is measured at the wavelength of 620 nm.

The microtiter plates are incubated at 20° C. and 85% relative humidity. The inhibition of growth is determined again photometrically 3-5 days after the application. Efficacy is calculated in relation to the untreated control, 0% efficacy means fungal growth as high as in untreated control while 100% efficacy means no fungal growth is measured.

The invention is illustrated by the following example. However the invention is not limited to the example.

TABLE A1
in vitro-Test with Alternaria alternate

| | | | | | | Colby |
|---|---|---|---|---|---|---|
| | | (2.038) | (3.025) | | | ex- |
| | (7.005) | iso- | fen- | | Effi- | pected |
| (I-655) | pyrimethanil | flucypram | picoxamid | | cacy | value |
| (ppm) | (ppm) | (ppm) | (ppm) | Ratio | % | % |
| 0.5 | | | | | 100 | |
| 0.1 | | | | | 20 | |
| 0.02 | | | | | 0 | |
| 0.004 | | | | | 0 | |
| | 20 | | | | 100 | |
| | 4 | | | | 99 | |
| | 0.8 | | | | 88 | |
| | 0.16 | | | | 3 | |
| | | 1.0 | | | 74 | |
| | | 0.2 | | | 85 | |
| | | 0.04 | | | 69 | |
| | | 0.008 | | | 44 | |
| | | | 5.0 | | 80 | |
| | | | 1.0 | | 47 | |
| | | | 0.2 | | 10 | |
| | | | 0.04 | | 0 | |
| 0.02 | 20 | | | 1:1000 | 100 | 100 |
| 0.02 | 4 | | | 1:200 | 100 | 100 |
| 0.02 | 0.8 | | | 1:40 | 100 | 96 |
| 0.02 | 0.16 | | | 1:8 | 100 | 69 |
| 0.5 | | 1.0 | | 1:2 | 100 | 100 |
| 0.5 | | 0.2 | | 1:0.4 | 100 | 100 |
| 0.5 | | 0.04 | | 1:0.08 | 99 | 100 |
| 0.5 | | 0.008 | | 1:0.016 | 100 | 100 |
| 0.1 | | 1.0 | | 1:10 | 99 | 79 |
| 0.1 | | 0.2 | | 1:2 | 96 | 88 |
| 0.1 | | 0.04 | | 1:0.4 | 94 | 75 |
| 0.1 | | 0.008 | | 1:0.08 | 86 | 56 |
| 0.02 | | 1.0 | | 1:50 | 97 | 74 |
| 0.02 | | 0.2 | | 1:10 | 97 | 85 |
| 0.02 | | 0.04 | | 1:2 | 86 | 69 |
| 0.02 | | 0.008 | | 1:0.4 | 87 | 45 |
| 0.004 | | 1.0 | | 1:250 | 97 | 74 |
| 0.004 | | 0.2 | | 1:50 | 98 | 85 |
| 0.004 | | 0.04 | | 1:10 | 87 | 69 |
| 0.02 | | | 5.0 | 1:250 | 87 | 80 |
| 0.02 | | | 1.0 | 1:50 | 67 | 47 |
| 0.02 | | | 0.2 | 1:10 | 13 | 10 |
| 0.02 | | | 0.04 | 1:2 | 5 | 0 |

TABLE A2
in vitro -Test with Alternaria alternate

| | (3.020) | (1.002) | (1.055) | (1.018) | | | |
|---|---|---|---|---|---|---|---|
| | trifloxy- | difeno- | mefentriflu- | prothio- | | | Colby |
| (I-655) | strobin | conazole | conazole | conazole | | | expected |
| (ppm) | (ppm) | (ppm) | (ppm) | (ppm) | Ratio | Efficacy % | value % |
| 0.5 | | | | | | 100 | |
| 0.1 | | | | | | 20 | |
| 0.020 | | | | | | 0 | |
| 0.004 | | | | | | 0 | |
| | 1.0 | | | | | 98 | |
| | 0.2 | | | | | 90 | |
| | 0.04 | | | | | 84 | |
| | 0.008 | | | | | 56 | |
| | | 1.0 | | | | 98 | |
| | | 0.2 | | | | 22 | |
| | | 0.008 | | | | 8 | |
| | | | 1.0 | | | 100 | |
| | | | 0.2 | | | 99 | |
| | | | 0.04 | | | 23 | |
| | | | 0.008 | | | 0 | |
| | | | | 1.0 | | 100 | |
| | | | | 0.2 | | 100 | |
| | | | | 0.04 | | 57 | |
| | | | | 0.008 | | 0 | |
| 0.5 | 1.0 | | | | 1:2 | 100 | 100 |
| 0.5 | 0.2 | | | | 1:0.4 | 100 | 100 |
| 0.5 | 0.04 | | | | 1:0.08 | 100 | 96 |
| 0.5 | 0.008 | | | | 1:0.016 | 100 | 69 |
| 0.02 | 1.0 | | | | 1:50 | 98 | 98 |
| 0.02 | 0.2 | | | | 1:10 | 96 | 90 |
| 0.02 | 0.04 | | | | 1:2 | 84 | 84 |
| 0.02 | 0.008 | | | | 1:0.4 | 55 | 57 |
| 0.5 | | 1.0 | | | 1:2 | 100 | 100 |
| 0.5 | | 0.2 | | | 1:0.4 | 100 | 100 |
| 0.5 | | 0.008 | | | 1:0.016 | 100 | 100 |
| 0.1 | | 1.0 | | | 1:10 | 98 | 99 |
| 0.1 | | 0.2 | | | 1:2 | 52 | 38 |
| 0.1 | | 0.008 | | | 1:0.08 | 34 | 26 |
| 0.02 | | 1.0 | | | 1:50 | 100 | 98 |
| 0.02 | | 0.2 | | | 1:10 | 42 | 23 |
| 0.02 | | 0.008 | | | 1:0.4 | 0 | 8 |
| 0.5 | | | 1.0 | | 1:2 | 100 | 100 |
| 0.5 | | | 0.2 | | 1:0.4 | 100 | 100 |
| 0.5 | | | 0.04 | | 1:0.08 | 100 | 100 |
| 0.5 | | | 0.008 | | 1:0.016 | 100 | 100 |
| 0.1 | | | 1.0 | | 1:10 | 100 | 100 |
| 0.1 | | | 0.2 | | 1:2 | 100 | 99 |
| 0.1 | | | 0.04 | | 1:0.4 | 56 | 24 |
| 0.1 | | | 0.008 | | 1:0.08 | 16 | 2 |
| 0.020 | | | 1.0 | | 1:50 | 99 | 100 |
| 0.020 | | | 0.2 | | 1:10 | 99 | 99 |
| 0.020 | | | 0.04 | | 1:2 | 89 | 23 |
| 0.020 | | | 0.008 | | 1:0.4 | 2 | 0 |
| 0.1 | | | | 1.0 | 1:10 | 100 | 100 |
| 0.1 | | | | 0.2 | 1:2 | 99 | 100 |
| 0.1 | | | | 0.04 | 1:0.4 | 67 | 57 |
| 0.1 | | | | 0.008 | 1:0.08 | 0 | 2 |
| 0.004 | | | | 1.0 | 1:250 | 100 | 100 |
| 0.004 | | | | 0.2 | 1:50 | 99 | 100 |
| 0.004 | | | | 0.04 | 1:10 | 64 | 57 |
| 0.004 | | | | 0.008 | 1:2 | 28 | 0 |

TABLE A3
in vitro -Test with Alternaria alternate

| | (1.021) | (1.020) | (13.001) | | | Colby |
|---|---|---|---|---|---|---|
| (I-655) | tebuconazole | spiroxamine | fludioxonil | | | expected |
| (ppm) | (ppm) | (ppm) | (ppm) | Ratio | Efficacy % | value % |
| 0.5 | | | | | 100 | |
| 0.1 | | | | | 20 | |
| 0.020 | | | | | 0 | |
| 0.004 | | | | | 0 | |
| | 1.0 | | | | 98 | |
| | 0.2 | | | | 32 | |
| | 0.04 | | | | 9 | |
| | 0.008 | | | | 11 | |
| | | 4 | | | 1 | |
| | | 0.8 | | | 1 | |
| | | 0.16 | | | 9 | |
| | | | 5.0 | | 100 | |
| | | | 1.0 | | 87 | |
| | | | 0.2 | | 0 | |
| | | | 0.04 | | 0 | |
| 0.5 | 1.0 | | | 1:2 | 100 | 100 |
| 0.5 | 0.2 | | | 1:0.4 | 99 | 100 |
| 0.5 | 0.04 | | | 1:0.08 | 100 | 100 |
| 0.5 | 0.008 | | | 1:0.016 | 100 | 100 |
| 0.1 | 1.0 | | | 1:10 | 98 | 98 |
| 0.1 | 0.2 | | | 1:2 | 35 | 33 |
| 0.1 | 0.04 | | | 1:0.4 | 27 | 11 |
| 0.1 | 0.008 | | | 1:0.08 | 24 | 12 |
| 0.5 | | 4 | | 1:8 | 100 | 100 |
| 0.5 | | 0.8 | | 1:1.6 | 100 | 100 |
| 0.5 | | 0.16 | | 1:0.32 | 100 | 100 |
| 0.1 | | 4 | | 1:40 | 22 | 1 |
| 0.1 | | 0.8 | | 1:8 | 0 | 1 |
| 0.1 | | 0.16 | | 1:1.6 | 19 | 9 |
| 0.5 | | | 5.0 | 1:10 | 100 | 100 |
| 0.5 | | | 1.0 | 1:2 | 100 | 100 |
| 0.5 | | | 0.2 | 1:0.4 | 100 | 100 |
| 0.5 | | | 0.04 | 1:0.08 | 100 | 100 |
| 0.1 | | | 5.0 | 1:50 | 100 | 100 |
| 0.1 | | | 1.0 | 1:10 | 96 | 87 |
| 0.1 | | | 0.2 | 1:2 | 80 | 0 |
| 0.1 | | | 0.04 | 1:0.4 | 7 | 0 |

TABLE A4
in vitro -Test with Alternaria alternate

| | (13.004) | (5.003) | (5.010) | | | Colby |
|---|---|---|---|---|---|---|
| (I-655) | proquinazid | captan | dithianon | | | expected |
| (ppm) | (ppm) | (ppm) | (ppm) | Ratio | Efficacy % | value % |
| 0.5 | | | | | 100 | |
| 0.1 | | | | | 20 | |
| 0.020 | | | | | 0 | |
| 0.004 | | | | | 0 | |
| | 10 | | | | 0 | |
| | 2 | | | | 0 | |
| | 0.4 | | | | 0 | |
| | 0.08 | | | | 0 | |
| | | 20 | | | 83 | |
| | | 4 | | | 21 | |
| | | 0.16 | | | 0 | |
| | | | 20 | | 100 | |
| | | | 4 | | 71 | |
| | | | 0.8 | | 0 | |
| 0.5 | 10 | | | 1:20 | 100 | 100 |
| 0.5 | 2 | | | 1:4 | 100 | 100 |
| 0.5 | 0.4 | | | 1:0.8 | 100 | 100 |
| 0.5 | 0.08 | | | 1:0.16 | 100 | 100 |
| 0.1 | 10 | | | 1:100 | 22 | 0 |
| 0.1 | 2 | | | 1:20 | 19 | 0 |
| 0.1 | 0.4 | | | 1:4 | 4 | 0 |
| 0.1 | 0.08 | | | 1:0.8 | 0 | 0 |
| 0.5 | | 20 | | 1:40 | 100 | 100 |
| 0.5 | | 4 | | 1:8 | 100 | 100 |
| 0.5 | | 0.16 | | 1:0.32 | 100 | 100 |
| 0.1 | | 20 | | 1:200 | 96 | 86 |
| 0.1 | | 4 | | 1:40 | 59 | 35 |
| 0.1 | | 0.16 | | 1:1.6 | 14 | 18 |
| 0.5 | | | 20 | 1:40 | 100 | 100 |
| 0.5 | | | 4 | 1:8 | 100 | 100 |
| 0.5 | | | 0.8 | 1:1.6 | 100 | 100 |
| 0.1 | | | 20 | 1:200 | 100 | 100 |
| 0.1 | | | 4 | 1:40 | 100 | 76 |
| 0.1 | | | 0.8 | 1:8 | 19 | 18 |
| 0.004 | | | 20 | 1:5000 | 99 | 100 |
| 0.004 | | | 4 | 1:1000 | 76 | 71 |
| 0.004 | | | 0.8 | 1:200 | 5 | 0 |

TABLE A5
in vitro -Test with Alternaria alternate

| | (5.012) | (5.018) | | | Colby |
|---|---|---|---|---|---|
| (I-655) | folpet | propineb | | Efficacy | expected |
| (ppm) | (ppm) | (ppm) | Ratio | % | value % |
| 0.5 | | | | 100 | |
| 0.1 | | | | 20 | |
| 0.020 | | | | 0 | |
| 0.004 | | | | 0 | |
| | 10 | | | 100 | |
| | 2 | | | 100 | |
| | 0.4 | | | 0 | |
| | | 100 | | 92 | |
| | | 20 | | 66 | |
| | | 4 | | 32 | |
| | | 0.8 | | 18 | |
| 0.5 | 10 | | 1:20 | 100 | 100 |
| 0.5 | 2 | | 1:4 | 100 | 100 |
| 0.5 | 0.4 | | 1:0.8 | 100 | 100 |
| 0.1 | 10 | | 1:100 | 100 | 100 |
| 0.1 | 2 | | 1:20 | 100 | 100 |
| 0.1 | 0.4 | | 1:4 | 47 | 18 |
| 0.020 | 10 | | 1:500 | 100 | 100 |
| 0.020 | 2 | | 1:100 | 100 | 100 |
| 0.020 | 0.4 | | 1:20 | 25 | 8 |
| 0.004 | 10 | | 1:2500 | 100 | 100 |
| 0.004 | 2 | | 1:500 | 100 | 100 |
| 0.004 | 0.4 | | 1:100 | 13 | 0 |
| 0.5 | | 100 | 1:200 | 100 | 100 |
| 0.5 | | 20 | 1:40 | 100 | 100 |
| 0.5 | | 4 | 1:8 | 100 | 100 |
| 0.5 | | 0.8 | 1:1.6 | 100 | 100 |
| 0.1 | | 20 | 1:200 | 70 | 69 |
| 0.1 | | 4 | 1:40 | 67 | 38 |
| 0.1 | | 0.8 | 1:8 | 28 | 26 |
| 0.004 | | 100 | 1:25000 | 96 | 92 |
| 0.004 | | 20 | 1:5000 | 65 | 66 |
| 0.004 | | 4 | 1:1000 | 31 | 32 |
| 0.004 | | 0.8 | 1:200 | 20 | 18 |

TABLE A6
in vitro -Test with Alternaria alternate

| | (15.012) | (17.012) | | | |
|---|---|---|---|---|---|
| | fosetylalu- | Paenibacillus | | | Colby |
| (I-655) | minium | terrae | | Efficacy | expected |
| (ppm) | (ppm) | (ppm) | Ratio | % | value % |
| 0.5 | | | | 100 | |
| 0.1 | | | | 20 | |
| 0.020 | | | | 0 | |
| 0.004 | | | | 0 | |
| | 100 | | | 37 | |
| | 20 | | | 27 | |
| | 4 | | | 8 | |
| | | 200 | | 100 | |
| | | 40 | | 13 | |
| | | 8 | | 1 | |
| 0.5 | 100 | | 1:200 | 100 | 100 |
| 0.5 | 20 | | 1:40 | 100 | 100 |
| 0.5 | 4 | | 1:8 | 100 | 100 |
| 0.004 | 100 | | 1:25000 | 43 | 37 |
| 0.004 | 20 | | 1:5000 | 27 | 27 |
| 0.004 | 4 | | 1:1000 | 22 | 8 |
| 0.5 | | 200 | 1:400 | 100 | 100 |
| 0.5 | | 40 | 1:80 | 99 | 100 |
| 0.5 | | 8 | 1:16 | 100 | 100 |
| 0.1 | | 200 | 1:2000 | 100 | 100 |
| 0.1 | | 40 | 1:400 | 66 | 31 |
| 0.1 | | 8 | 1:80 | 26 | 21 |

TABLE A7
in vitro -Test with Alternaria alternate

| | (7.005) | (2.002) | (2.005) | | | Colby |
|---|---|---|---|---|---|---|
| (I-746) | pyrimethanil | bixafen | fluopyram | | | expected |
| (ppm) | (ppm) | (ppm) | (ppm) | Ratio | Efficacy % | value % |
| 0.5 | | | | | 100 | |
| 0.1 | | | | | 22 | |
| 0.020 | | | | | 0 | |
| 0.004 | | | | | 0 | |
| | 20 | | | | 100 | |
| | 4 | | | | 100 | |
| | 0.8 | | | | 96 | |
| | 0.16 | | | | 1 | |
| | | 1.0 | | | 86 | |
| | | 0.2 | | | 81 | |
| | | 0.04 | | | 79 | |
| | | | 4 | | 94 | |
| | | | 0.8 | | 77 | |
| | | | 0.16 | | 72 | |
| 0.1 | 20 | | | 1:200 | 100 | 100 |
| 0.1 | 4 | | | 1:40 | 100 | 100 |
| 0.1 | 0.8 | | | 1:8 | 100 | 96 |
| 0.1 | 0.16 | | | 1:1.6 | 47 | 9 |
| 0.004 | | 1.0 | | 1:250 | 97 | 86 |
| 0.004 | | 0.2 | | 1:50 | 81 | 81 |
| 0.004 | | 0.04 | | 1:10 | 80 | 79 |
| 0.5 | | | 4 | 1:8 | 99 | 100 |
| 0.5 | | | 0.8 | 1:1.6 | 100 | 100 |
| 0.5 | | | 0.16 | 1:0.32 | 100 | 100 |
| 0.1 | | | 4 | 1:8 | 95 | 95 |
| 0.1 | | | 0.8 | 1:1.6 | 90 | 79 |
| 0.1 | | | 0.16 | 1:0.32 | 76 | 74 |
| 0.020 | | | 4 | 1:8 | 96 | 94 |
| 0.020 | | | 0.8 | 1:1.6 | 78 | 77 |
| 0.020 | | | 0.16 | 1:0.32 | 75 | 72 |
| 0.1 | | | 4 | 1:8 | 92 | 94 |
| 0.1 | | | 0.8 | 1:1.6 | 87 | 77 |
| 0.1 | | | 0.16 | 1:0.32 | 81 | 72 |

TABLE A8
in vitro -Test with Alternaria alternate

| | (2.038) | (3.025) | | | Colby |
|---|---|---|---|---|---|
| (I-746) | isoflucypram | fenpicoxamid | | Efficacy | expected |
| (ppm) | (ppm) | (ppm) | Ratio | % | value % |
| 0.5 | | | | 100 | |
| 0.1 | | | | 22 | |
| 0.020 | | | | 0 | |
| 0.004 | | | | 0 | |
| | 0.2 | | | 81 | |
| | 0.04 | | | 76 | |
| | 0.008 | | | 41 | |
| | | 5.0 | | 81 | |
| | | 1.0 | | 14 | |
| | | 0.2 | | 4 | |
| | | 0.04 | | 11 | |
| 0.5 | 0.2 | | 1:0.4 | 100 | 100 |
| 0.5 | 0.04 | | 1:0.08 | 100 | 100 |
| 0.5 | 0.008 | | 1:0.016 | 100 | 100 |
| 0.1 | 0.2 | | 1:2 | 82 | 82 |
| 0.1 | 0.04 | | 1:0.4 | 86 | 77 |
| 0.1 | 0.008 | | 1:0.08 | 59 | 44 |
| 0.020 | 0.2 | | 1:10 | 77 | 81 |
| 0.020 | 0.04 | | 1:2 | 81 | 76 |
| 0.020 | 0.008 | | 1:0.4 | 50 | 41 |
| 0.004 | 0.2 | | 1:50 | 89 | 82 |
| 0.004 | 0.04 | | 1:10 | 76 | 76 |
| 0.004 | 0.008 | | 1:2 | 56 | 42 |
| 0.5 | | 5.0 | 1:10 | 100 | 100 |
| 0.5 | | 1.0 | 1:2 | 100 | 100 |
| 0.5 | | 0.2 | 1:0.4 | 100 | 100 |
| 0.5 | | 0.04 | 1:0.08 | 100 | 100 |
| 0.1 | | 5.0 | 1:50 | 83 | 82 |
| 0.1 | | 1.0 | 1:10 | 56 | 17 |
| 0.1 | | 0.2 | 1:2 | 11 | 9 |
| 0.1 | | 0.04 | 1:0.4 | 23 | 15 |
| 0.020 | | 5.0 | 1:250 | 80 | 81 |
| 0.020 | | 1.0 | 1:50 | 20 | 14 |
| 0.020 | | 0.2 | 1:10 | 6 | 4 |
| 0.020 | | 0.04 | 1:2 | 15 | 11 |

TABLE A9
in vitro -Test with Alternaria alternate

| | (1.002) | (1.055) | (1.018) | | | |
|---|---|---|---|---|---|---|
| | difeno- | mefen-triflu- | prothio- | | | Colby |
| (I-746) | conazole | conazole | conazole | | | expected |
| (ppm) | (ppm) | (ppm) | (ppm) | Ratio | Efficacy % | value % |
| 0.5 | | | | | 100 | |
| 0.1 | | | | | 22 | |
| 0.020 | | | | | 0 | |
| 0.004 | | | | | 0 | |
| | 1.0 | | | | 92 | |
| | 0.2 | | | | 51 | |
| | 0.04 | | | | 4 | |
| | 0.008 | | | | 8 | |
| | | 1.0 | | | 100 | |
| | | 0.2 | | | 100 | |
| | | 0.04 | | | 54 | |
| | | 0.008 | | | 0 | |
| | | | 1.0 | | 100 | |
| | | | 0.2 | | 99 | |
| | | | 0.04 | | 31 | |
| 0.5 | 1.0 | | | 1:2 | 100 | 100 |
| 0.5 | 0.2 | | | 1:0.4 | 100 | 100 |
| 0.5 | 0.04 | | | 1:0.08 | 100 | 100 |
| 0.5 | 0.008 | | | 1:0.016 | 100 | 100 |
| 0.020 | 1.0 | | | 1:50 | 96 | 92 |
| 0.020 | 0.2 | | | 1:10 | 68 | 51 |
| 0.020 | 0.04 | | | 1:2 | 1 | 4 |
| 0.020 | 0.008 | | | 1:0.4 | 11 | 8 |
| 0.5 | | 1.0 | | 1:2 | 100 | 100 |
| 0.5 | | 0.2 | | 1:0.4 | 100 | 100 |
| 0.5 | | 0.04 | | 1:0.08 | 100 | 100 |
| 0.5 | | 0.008 | | 1:0.016 | 100 | 100 |
| 0.020 | | 1.0 | | 1:50 | 100 | 100 |
| 0.020 | | 0.2 | | 1:10 | 100 | 100 |
| 0.020 | | 0.04 | | 1:2 | 67 | 54 |
| 0.020 | | 0.008 | | 1:0.4 | 10 | 0 |
| 0.1 | | | 1.0 | 1:10 | 100 | 100 |
| 0.1 | | | 0.2 | 1:2 | 100 | 99 |
| 0.1 | | | 0.04 | 1:0.4 | 88 | 35 |
| 0.020 | | | 1.0 | 1:50 | 100 | 100 |
| 0.020 | | | 0.2 | 1:10 | 100 | 99 |
| 0.020 | | | 0.04 | 1:2 | 48 | 31 |

TABLE A10
in vitro -Test with Alternaria alternate

| | (1.021) | (13.001) | | | Colby |
|---|---|---|---|---|---|
| (I-746) | tebuconazole | fludioxonil | | Efficacy | expected |
| (ppm) | (ppm) | (ppm) | Ratio | % | value % |
| 0.5 | | | | 100 | |
| 0.1 | | | | 22 | |
| 0.020 | | | | 0 | |
| 0.004 | | | | 0 | |
| | 1.0 | | | 96 | |
| | 0.2 | | | 22 | |
| | 0.04 | | | 15 | |
| | 0.008 | | | 10 | |
| | | 5.0 | | 100 | |
| | | 1.0 | | 89 | |
| | | 0.04 | | 0 | |
| 0.5 | 1.0 | | 1:2 | 100 | 100 |
| 0.5 | 0.04 | | 1:0.08 | 100 | 100 |
| 0.5 | 0.008 | | 1:0.016 | 100 | 100 |
| 0.020 | 1.0 | | 1:50 | 98 | 96 |
| 0.020 | 0.2 | | 1:10 | 24 | 22 |
| 0.020 | 0.04 | | 1:2 | 11 | 15 |
| 0.020 | 0.008 | | 1:0.4 | 16 | 10 |
| 0.5 | | 5.0 | 1:10 | 100 | 100 |
| 0.5 | | 1.0 | 1:2 | 100 | 100 |
| 0.5 | | 0.04 | 1:0.08 | 100 | 100 |
| 0.020 | | 5.0 | 1:250 | 100 | 100 |
| 0.020 | | 1.0 | 1:50 | 85 | 89 |
| 0.020 | | 0.04 | 1:2 | 4 | 0 |
| 0.004 | | 5.0 | 1:1250 | 97 | 100 |
| 0.004 | | 1.0 | 1:250 | 89 | 89 |
| 0.004 | | 0.04 | 1:10 | 16 | 0 |

TABLE A11
in vitro -Test with Alternaria alternate

| | (5.003) | (5.010) | (5.018) | (6.002) | | | Colby |
|---|---|---|---|---|---|---|---|
| (I-746) | captan | dithianon | propineb | isotianil | | | expected |
| (ppm) | (ppm) | (ppm) | (ppm) | (ppm) | Ratio | Efficacy % | value % |
| 0.5 | | | | | | 100 | |
| 0.1 | | | | | | 22 | |
| 0.020 | | | | | | 0 | |
| 0.004 | | | | | | 0 | |
| | 20 | | | | | 100 | |
| | 4 | | | | | 66 | |
| | 0.16 | | | | | 2 | |
| | | 20 | | | | 100 | |
| | | 4 | | | | 81 | |
| | | | 20 | | | 71 | |
| | | | 4 | | | 21 | |
| | | | 0.8 | | | 11 | |
| | | | | 100 | | 0 | |
| | | | | 20 | | 7 | |
| | | | | 4 | | 0 | |
| 0.5 | 20 | | | | 1:40 | 100 | 100 |
| 0.5 | 4 | | | | 1:8 | 100 | 100 |
| 0.5 | 0.16 | | | | 1:0.32 | 100 | 100 |
| 0.1 | 20 | | | | 1:200 | 100 | 100 |
| 0.1 | 4 | | | | 1:40 | 87 | 73 |
| 0.1 | 0.16 | | | | 1:1.6 | 26 | 25 |
| 0.004 | 20 | | | | 1:5000 | 100 | 100 |
| 0.004 | 4 | | | | 1:1000 | 83 | 66 |
| 0.004 | 0.16 | | | | 1:40 | 13 | 2 |
| 0.5 | | 20 | | | 1:40 | 100 | 100 |
| 0.5 | | 4 | | | 1:8 | 100 | 100 |
| 0.1 | | 20 | | | 1:200 | 100 | 100 |
| 0.1 | | 4 | | | 1:40 | 100 | 86 |
| 0.020 | | 20 | | | 1:1000 | 100 | 100 |
| 0.020 | | 4 | | | 1:200 | 89 | 83 |
| 0.004 | | 20 | | | 1:5000 | 100 | 100 |
| 0.004 | | 4 | | | 1:1000 | 80 | 81 |
| 0.5 | | | 20 | | 1:40 | 100 | 100 |
| 0.5 | | | 4 | | 1:8 | 100 | 100 |
| 0.5 | | | 0.8 | | 1:1.6 | 100 | 100 |
| 0.1 | | | 20 | | 1:200 | 83 | 71 |
| 0.1 | | | 4 | | 1:40 | 64 | 21 |
| 0.1 | | | 0.8 | | 1:8 | 16 | 11 |
| 0.020 | | | 20 | | 1:1000 | 93 | 72 |
| 0.020 | | | 4 | | 1:200 | 47 | 23 |
| 0.020 | | | 0.8 | | 1:40 | 31 | 14 |
| 0.004 | | | 20 | | 1:5000 | 69 | 71 |
| 0.004 | | | 4 | | 1:1000 | 29 | 21 |
| 0.004 | | | 0.8 | | 1:200 | 23 | 11 |
| 0.5 | | | | 100 | 1:200 | 100 | 100 |
| 0.5 | | | | 20 | 1:40 | 100 | 100 |
| 0.5 | | | | 4 | 1:8 | 100 | 100 |
| 0.1 | | | | 100 | 1:1000 | 33 | 10 |
| 0.1 | | | | 20 | 1:200 | 23 | 16 |
| 0.1 | | | | 4 | 1:40 | 11 | 10 |
| 0.004 | | | | 100 | 1:25000 | 0 | 0 |
| 0.004 | | | | 20 | 1:5000 | 12 | 7 |
| 0.004 | | | | 4 | 1:1000 | 16 | 0 |

TABLE A12
in vitro -Test with Alternaria alternate

| | (7.005) | (2.005) | | | Colby |
|---|---|---|---|---|---|
| (I-749) | pyrimethanil | fluopyram | | Efficacy | expected |
| (ppm) | (ppm) | (ppm) | Ratio | % | value % |
| 0.5 | | | | 100 | |
| 0.1 | | | | 24 | |
| 0.020 | | | | 14 | |
| 0.004 | | | | 0 | |
| | 20 | | | 100 | |
| | 4 | | | 100 | |
| | 0.8 | | | 100 | |
| | 0.16 | | | 25 | |
| | | 20 | | 99 | |
| | | 4 | | 85 | |
| | | 0.8 | | 81 | |
| | | 0.16 | | 63 | |
| 0.1 | 20 | | 1:200 | 100 | 100 |
| 0.1 | 4 | | 1:40 | 100 | 100 |
| 0.1 | 0.8 | | 1:8 | 100 | 100 |
| 0.1 | 0.16 | | 1:1.6 | 100 | 62 |
| 0.020 | 20 | | 1:1000 | 100 | 100 |
| 0.020 | 4 | | 1:200 | 100 | 100 |
| 0.020 | 0.8 | | 1:40 | 100 | 100 |
| 0.020 | 0.16 | | 1:8 | 100 | 25 |
| 0.004 | 20 | | 1:5000 | 100 | 100 |
| 0.004 | 4 | | 1:1000 | 100 | 100 |
| 0.004 | 0.8 | | 1:200 | 100 | 100 |
| 0.004 | 0.16 | | 1:40 | 90 | 29 |
| 0.5 | | 20 | 1:40 | 100 | 100 |
| 0.5 | | 4 | 1:8 | 99 | 100 |
| 0.5 | | 0.8 | 1:1.6 | 100 | 100 |
| 0.5 | | 0.16 | 1:0.32 | 100 | 100 |
| 0.020 | | 20 | 1:1000 | 97 | 99 |
| 0.020 | | 4 | 1:200 | 91 | 85 |
| 0.020 | | 0.16 | 1:8 | 58 | 63 |
| 0.004 | | 20 | 1:5000 | 98 | 99 |
| 0.004 | | 4 | 1:1000 | 90 | 86 |
| 0.004 | | 0.8 | 1:200 | 86 | 82 |
| 0.004 | | 0.16 | 1:40 | 66 | 65 |

TABLE A13
in vitro -Test with Alternaria alternate

| | (2.028) | (2.038) | (3.025) | | | Colby |
|---|---|---|---|---|---|---|
| (I-749) | inpyrfluxam | isoflucypram | fenpicoxamid | | | expected |
| (ppm) | (ppm) | (ppm) | (ppm) | Ratio | Efficacy % | value % |
| 0.5 | | | | | 100 | |
| 0.1 | | | | | 24 | |
| 0.020 | | | | | 14 | |
| 0.004 | | | | | 0 | |
| | 1.0 | | | | 79 | |
| | 0.2 | | | | 73 | |
| | 0.04 | | | | 57 | |
| | 0.008 | | | | 0 | |
| | | 0.2 | | | 73 | |
| | | 0.04 | | | 71 | |
| | | 0.008 | | | 53 | |
| | | | 5.0 | | 64 | |
| 0.5 | 1.0 | | | 1:2 | 100 | 100 |
| 0.5 | 0.2 | | | 1:0.4 | 100 | 100 |
| 0.5 | 0.04 | | | 1:0.08 | 100 | 100 |
| 0.5 | 0.008 | | | 1:0.016 | 100 | 92 |
| 0.020 | 1.0 | | | 1:50 | 93 | 79 |
| 0.020 | 0.2 | | | 1:10 | 75 | 73 |
| 0.020 | 0.04 | | | 1:2 | 63 | 57 |
| 0.020 | 0.008 | | | 1:0.4 | 1 | 0 |
| 0.004 | 1.0 | | | 1:250 | 85 | 80 |
| 0.004 | 0.2 | | | 1:50 | 78 | 74 |
| 0.004 | 0.04 | | | 1:10 | 56 | 59 |
| 0.004 | 0.008 | | | 1:2 | 0 | 5 |
| 0.5 | | 0.2 | | 1:0.4 | 100 | 100 |
| 0.5 | | 0.04 | | 1:0.08 | 100 | 100 |
| 0.5 | | 0.008 | | 1:0.016 | 100 | 100 |
| 0.1 | | 0.2 | | 1:2 | 85 | 77 |
| 0.1 | | 0.04 | | 1:0.4 | 75 | 75 |
| 0.1 | | 0.008 | | 1:0.08 | 56 | 59 |
| 0.020 | | 0.2 | | 1:10 | 90 | 73 |
| 0.020 | | 0.04 | | 1:2 | 74 | 71 |
| 0.020 | | 0.008 | | 1:0.4 | 68 | 53 |
| 0.004 | | 0.2 | | 1:50 | 79 | 74 |
| 0.004 | | 0.04 | | 1:10 | 80 | 72 |
| 0.004 | | 0.008 | | 1:2 | 60 | 54 |
| 0.5 | | | 5.0 | 1:10 | 100 | 100 |
| 0.1 | | | 5.0 | 1:50 | 81 | 69 |
| 0.020 | | | 5.0 | 1:250 | 69 | 64 |
| 0.004 | | | 5.0 | 1:1250 | 71 | 65 |

TABLE A14
in vitro -Test with Alternaria alternate

| | (3.020) | (1.002) | (1.018) | | | |
|---|---|---|---|---|---|---|
| | trifloxy- | difeno- | prothio- | | | Colby |
| (I-749) | strobin | conazole | conazole | | Efficacy | expected |
| (ppm) | (ppm) | (ppm) | (ppm) | Ratio | % | value % |
| 0.5 | | | | | 100 | |
| 0.1 | | | | | 24 | |
| 0.020 | | | | | 14 | |
| 0.004 | | | | | 0 | |
| | 0.2 | | | | 87 | |
| | 0.04 | | | | 82 | |
| | 0.008 | | | | 51 | |
| | | 1.0 | | | 96 | |
| | | 0.2 | | | 3 | |
| | | 0.008 | | | 11 | |
| | | | 1.0 | | 100 | |
| | | | 0.2 | | 99 | |
| | | | 0.04 | | 32 | |
| 0.1 | 0.2 | | | 1:2 | 93 | 89 |
| 0.1 | 0.04 | | | 1:0.4 | 84 | 84 |
| 0.1 | 0.008 | | | 1:0.08 | 57 | 57 |
| 0.020 | 0.2 | | | 1:10 | 93 | 87 |
| 0.020 | 0.04 | | | 1:2 | 84 | 82 |
| 0.020 | 0.008 | | | 1:0.4 | 76 | 51 |
| 0.004 | 0.2 | | | 1:50 | 96 | 88 |
| 0.004 | 0.04 | | | 1:10 | 90 | 82 |
| 0.004 | 0.008 | | | 1:2 | 62 | 52 |
| 0.5 | | 1.0 | | 1:2 | 100 | 100 |
| 0.5 | | 0.2 | | 1:0.4 | 99 | 100 |
| 0.5 | | 0.008 | | 1:0.016 | 100 | 100 |
| 0.1 | | 1.0 | | 1:10 | 97 | 96 |
| 0.1 | | 0.2 | | 1:2 | 53 | 16 |
| 0.1 | | 0.008 | | 1:0.08 | 27 | 23 |
| 0.020 | | 1.0 | | 1:50 | 94 | 96 |
| 0.020 | | 0.2 | | 1:10 | 54 | 3 |
| 0.020 | | 0.008 | | 1:0.4 | 0 | 11 |
| 0.004 | | 1.0 | | 1:250 | 97 | 96 |
| 0.004 | | 0.2 | | 1:50 | 23 | 5 |
| 0.004 | | 0.008 | | 1:2 | 17 | 13 |
| 0.1 | | | 1.0 | 1:10 | 100 | 100 |
| 0.1 | | | 0.2 | 1:2 | 99 | 99 |
| 0.1 | | | 0.04 | 1:0.4 | 73 | 66 |

TABLE A15
in vitro -Test with Alternaria alternate

| | (1.021) | (13.001) | (5.003) | | | Colby |
|---|---|---|---|---|---|---|
| (I-749) | tebucona- | fludioxonil | captan | | Efficacy | expected |
| (ppm) | zole (ppm) | (ppm) | (ppm) | Ratio | % | value % |
| 0.5 | | | | | 100 | |
| 0.1 | | | | | 24 | |
| 0.020 | | | | | 14 | |
| 0.004 | | | | | 0 | |
| | 1.0 | | | | 99 | |
| | 0.2 | | | | 48 | |
| | 0.04 | | | | 14 | |
| | 0.008 | | | | 0 | |
| | | 5.0 | | | 100 | |
| | | 1.0 | | | 96 | |
| | | 0.2 | | | 0 | |
| | | 0.04 | | | 0 | |
| | | | 20 | | 100 | |
| | | | 4 | | 100 | |
| | | | 0.8 | | 10 | |
| | | | 0.16 | | 13 | |
| 0.5 | 1.0 | | | 1:2 | 100 | 100 |
| 0.5 | 0.2 | | | 1:0.4 | 100 | 98 |
| 0.5 | 0.04 | | | 1:0.08 | 100 | 100 |
| 0.5 | 0.008 | | | 1:0.016 | 100 | 100 |
| 0.004 | 1.0 | | | 1:250 | 99 | 99 |
| 0.004 | 0.2 | | | 1:50 | 61 | 51 |
| 0.004 | 0.04 | | | 1:10 | 20 | 20 |
| 0.004 | 0.008 | | | 1:2 | 0 | 6 |
| 0.020 | | 5.0 | | 1:250 | 100 | 100 |
| 0.020 | | 1.0 | | 1:50 | 89 | 96 |
| 0.020 | | 0.2 | | 1:10 | 86 | 5 |
| 0.020 | | 0.04 | | 1:2 | 13 | 5 |
| 0.020 | | | 20 | 1:1000 | 100 | 100 |
| 0.020 | | | 4 | 1:200 | 100 | 100 |
| 0.020 | | | 0.8 | 1:40 | 38 | 23 |
| 0.020 | | | 0.16 | 1:8 | 26 | 25 |

TABLE A16
in vitro -Test with Alternaria alternate

| | (5.012) | (5.013) | (5.018) | | | Colby |
|---|---|---|---|---|---|---|
| (I-749) | folpet | mancozeb | propineb | | | expected |
| (ppm) | (ppm) | (ppm) | (ppm) | Ratio | Efficacy % | value % |
| 0.5 | | | | | 100 | |
| 0.1 | | | | | 24 | |
| 0.020 | | | | | 14 | |
| 0.004 | | | | | 0 | |
| | 10 | | | | 100 | |
| | 2 | | | | 100 | |
| | 0.4 | | | | 1 | |
| | 0.08 | | | | 5 | |
| | | 10 | | | 95 | |
| | | 2 | | | 6 | |
| | | | 100 | | 96 | |
| | | | 20 | | 73 | |
| | | | 4 | | 56 | |
| 0.020 | 10 | | | 1:500 | 100 | 100 |
| 0.020 | 2 | | | 1:100 | 100 | 100 |
| 0.020 | 0.4 | | | 1:20 | 60 | 15 |
| 0.020 | 0.08 | | | 1:4 | 25 | 18 |
| 0.004 | 10 | | | 1:2500 | 100 | 100 |
| 0.004 | 2 | | | 1:500 | 100 | 100 |
| 0.004 | 0.4 | | | 1:100 | 18 | 1 |
| 0.004 | 0.08 | | | 1:20 | 12 | 5 |
| 0.5 | | 10 | | 1:20 | 99 | 100 |
| 0.5 | | 2 | | 1:4 | 100 | 100 |
| 0.1 | | 10 | | 1:100 | 100 | 97 |
| 0.1 | | 2 | | 1:20 | 71 | 45 |
| 0.020 | | 10 | | 1:500 | 96 | 95 |
| 0.020 | | 2 | | 1:100 | 10 | 10 |
| 0.5 | | | 100 | 1:200 | 100 | 100 |
| 0.5 | | | 20 | 1:40 | 100 | 100 |
| 0.5 | | | 4 | 1:8 | 100 | 100 |
| 0.1 | | | 100 | 1:1000 | 95 | 98 |
| 0.1 | | | 20 | 1:200 | 98 | 84 |
| 0.1 | | | 4 | 1:40 | 68 | 74 |
| 0.020 | | | 100 | 1:5000 | 90 | 96 |
| 0.020 | | | 20 | 1:1000 | 98 | 74 |
| 0.020 | | | 4 | 1:200 | 67 | 58 |
| 0.004 | | | 100 | 1:25000 | 95 | 96 |
| 0.004 | | | 20 | 1:5000 | 80 | 75 |
| 0.004 | | | 4 | 1:1000 | 66 | 59 |

TABLE B1
in vitro -Test with Botrytis cinerea

| | (7.005) | (1.055) | (1.021) | | | |
|---|---|---|---|---|---|---|
| | pyrime- | mefentriflu- | tebu- | | | Colby |
| (I-655) | thanil | conazole | conazole | | | expected |
| (ppm) | (ppm) | (ppm) | (ppm) | Ratio | Efficacy % | value % |
| 0.5 | | | | | 100 | |
| 0.1 | | | | | 58 | |
| 0.020 | | | | | 0 | |
| 0.004 | | | | | 0 | |
| | 20 | | | | 100 | |
| | 4 | | | | 99 | |
| | 0.8 | | | | 96 | |
| | 0.16 | | | | 56 | |
| | | 1.0 | | | 100 | |
| | | 0.2 | | | 63 | |
| | | 0.04 | | | 36 | |
| | | | 1.0 | | 100 | |
| | | | 0.2 | | 20 | |
| | | | 0.04 | | 8 | |
| | | | 0.008 | | 0 | |
| 0.004 | 20 | | | 1:5000 | 100 | 100 |
| 0.004 | 4 | | | 1:1000 | 100 | 99 |
| 0.004 | 0.8 | | | 1:200 | 100 | 96 |
| 0.004 | 0.16 | | | 1:40 | 80 | 59 |
| 0.1 | | 1.0 | | 1:10 | 100 | 100 |
| 0.1 | | 0.2 | | 1:2 | 80 | 71 |
| 0.1 | | 0.04 | | 1:0.4 | 54 | 48 |
| 0.004 | | 1.0 | | 1:250 | 100 | 100 |
| 0.004 | | 0.2 | | 1:50 | 73 | 63 |
| 0.004 | | 0.04 | | 1:10 | 41 | 36 |
| 0.5 | | | 1.0 | 1:2 | 100 | 100 |
| 0.5 | | | 0.04 | 1:0.08 | 90 | 70 |
| 0.5 | | | 0.008 | 1:0.016 | 100 | 68 |
| 0.1 | | | 1.0 | 1:10 | 100 | 100 |
| 0.1 | | | 0.2 | 1:2 | 67 | 36 |
| 0.1 | | | 0.04 | 1:0.4 | 20 | 27 |
| 0.020 | | | 1.0 | 1:50 | 100 | 100 |
| 0.020 | | | 0.2 | 1:10 | 81 | 20 |
| 0.020 | | | 0.04 | 1:2 | 0 | 8 |
| 0.020 | | | 0.008 | 1:0.4 | 6 | 0 |
| 0.004 | | | 1.0 | 1:250 | 100 | 100 |
| 0.004 | | | 0.2 | 1:50 | 56 | 20 |
| 0.004 | | | 0.04 | 1:10 | 10 | 8 |
| 0.004 | | | 0.008 | 1:2 | 22 | 0 |

TABLE B2
in vitro -Test with Botrytis cinerea

| | (1.020) | | (13.001) | (13.004) | | | |
|---|---|---|---|---|---|---|---|
| | spiro- | | fludio- | pro- | | Effi- | Colby |
| (I-655) | xamine | (15.064) | xonil | quinazid | | cacy | expected |
| (ppm) | (ppm) | (ppm) | (ppm) | (ppm) | Ratio | % | value % |
| 0.5 | | | | | | 100 | |
| 0.1 | | | | | | 58 | |
| 0.020 | | | | | | 0 | |
| 0.004 | | | | | | 0 | |
| | 4 | | | | | 4 | |
| | 0.8 | | | | | 5 | |
| | 0.16 | | | | | 0 | |
| | | 2 | | | | 31 | |
| | | 0.4 | | | | 0 | |
| | | 0.080 | | | | 0 | |
| | | | 5.0 | | | 100 | |
| | | | 1.0 | | | 100 | |
| | | | 0.2 | | | 99 | |
| | | | 0.04 | | | 12 | |
| | | | | 10 | | 0 | |
| | | | | 2 | | 0 | |
| | | | | 0.4 | | 0 | |
| 0.5 | 4 | | | | 1:8 | 100 | 78 |
| 0.5 | 0.8 | | | | 1:1.6 | 100 | 78 |
| 0.5 | 0.16 | | | | 1:0.32 | 100 | 77 |
| 0.020 | 4 | | | | 1:200 | 15 | 4 |
| 0.020 | 0.8 | | | | 1:40 | 0 | 5 |
| 0.020 | 0.16 | | | | 1:8 | 0 | 0 |
| 0.5 | | 2 | | | 1:4 | 100 | 84 |
| 0.5 | | 0.4 | | | 1:0.8 | 100 | 77 |
| 0.5 | | 0.080 | | | 1:0.16 | 99 | 77 |
| 0.5 | | | 5.0 | | 1:10 | 100 | 100 |
| 0.5 | | | 1.0 | | 1:2 | 100 | 100 |
| 0.5 | | | 0.2 | | 1:0.4 | 100 | 100 |
| 0.5 | | | 0.04 | | 1:0.08 | 100 | 80 |
| 0.004 | | | 5.0 | | 1:1250 | 100 | 100 |
| 0.004 | | | 1.0 | | 1:250 | 100 | 100 |
| 0.004 | | | 0.2 | | 1:50 | 99 | 99 |
| 0.004 | | | 0.04 | | 1:10 | 29 | 18 |
| 0.5 | | | | 10 | 1:20 | 100 | 77 |
| 0.5 | | | | 2 | 1:4 | 100 | 77 |
| 0.5 | | | | 0.4 | 1:0.8 | 100 | 77 |
| 0.1 | | | | 10 | 1:100 | 55 | 36 |
| 0.1 | | | | 2 | 1:20 | 62 | 36 |
| 0.1 | | | | 0.4 | 1:4 | 50 | 36 |

TABLE B3
in vitro-Test with Botrytis cinerea

| | (5.010) | (15.016) | | | | |
|---|---|---|---|---|---|---|
| (1-655) | dithianon | metrafenone | (6.002) | | | |
| (ppm) | (ppm) | (ppm) | isotianil (ppm) | Ratio | Efficacy % | Colby expected value % |
| 0.5 | | | | | 100 | |
| 0.1 | | | | | 58 | |
| 0.020 | | | | | 0 | |
| 0.004 | | | | | 0 | |
| | 20 | | | | 100 | |
| | 4 | | | | 12 | |
| | | 4 | | | 0 | |
| | | 0.8 | | | 0 | |
| | | | 4 | | 0 | |
| | | | 0.8 | | 0 | |
| 0.5 | 20 | | | 1:40 | 100 | 100 |
| 0.5 | 4 | | | 1:8 | 100 | 100 |
| 0.1 | 20 | | | 1:200 | 100 | 100 |
| 0.1 | 4 | | | 1:40 | 100 | 63 |
| 0.020 | 20 | | | 1:1000 | 100 | 100 |
| 0.020 | 4 | | | 1:200 | 21 | 12 |
| 0.004 | 20 | | | 1:5000 | 100 | 100 |
| 0.004 | 4 | | | 1:1000 | 39 | 12 |
| 0.5 | | 4 | | 1:8 | 100 | 96 |
| 0.5 | | 0.8 | | 1:1.6 | 100 | 96 |
| 0.020 | | 4 | | 1:200 | 10 | 5 |
| 0.020 | | 0.8 | | 1:40 | 0 | 5 |
| 0.004 | | 4 | | 1:1000 | 19 | 17 |
| 0.004 | | 0.8 | | 1:200 | 19 | 17 |
| 0.5 | | | 4 | 1:8 | 100 | 84 |
| 0.5 | | | 0.8 | 1:1.6 | 100 | 84 |
| 0.020 | | | 4 | 1:200 | 0 | 0 |
| 0.020 | | | 0.8 | 1:40 | 1 | 0 |

TABLE B4
in vitro-Test with Botrytis cinerea

| | | (17.012) | | | | |
|---|---|---|---|---|---|---|
| | | Paeni- | | | | |
| | (17.001) | bacillus | | | | |
| | Bacillus subtilis | terrae | (18.001) | | | Colby |
| (1-655) (ppm) | (ppm) | (ppm) | FLiPPER (ppm) | Ratio | Efficacy % | expected value % |
| 0.5 | | | | | 100 | |
| 0.1 | | | | | 58 | |
| 0.020 | | | | | 0 | |
| 0.004 | | | | | 0 | |
| | 200 | | | | 100 | |
| | 40 | | | | 12 | |
| | 8 | | | | 0 | |
| | | 200 | | | 100 | |
| | | 40 | | | 0 | |
| | | 8 | | | 0 | |
| | | | 200 | | 0 | |
| | | | 40 | | 0 | |
| 0.020 | 200 | | | 1:10000 | 21 | 12 |
| 0.020 | 40 | | | 1:2000 | 7 | 2 |
| 0.020 | 8 | | | 1:400 | 0 | 0 |
| 0.004 | 200 | | | 1:50000 | 15 | 12 |
| 0.004 | 40 | | | 1:10000 | 14 | 2 |
| 0.004 | 8 | | | 1:2000 | 0 | 0 |
| 0.5 | | 200 | | 1:400 | 96 | 100 |
| 0.5 | | 40 | | 1:80 | 96 | 84 |
| 0.5 | | 8 | | 1:16 | 100 | 84 |
| 0.1 | | 200 | | 1:2000 | 100 | 100 |
| 0.1 | | 40 | | 1:400 | 31 | 29 |
| 0.5 | | | 200 | 1:400 | 89 | 84 |
| 0.5 | | | 40 | 1:80 | 100 | 84 |
| 0.1 | | | 200 | 1:2000 | 31 | 29 |
| 0.1 | | | 40 | 1:400 | 28 | 29 |
| 0.020 | | | 200 | 1:10000 | 0 | 0 |
| 0.020 | | | 40 | 1:2000 | 0 | 0 |

TABLE B5
in vitro-Test with Botrytis cinerea

| | (7.005) | | (2.005) | (2.028) | | | |
|---|---|---|---|---|---|---|---|
| (1-746) | pyrimethanil | (2.002) | fluopyram | inpyr- | | | Colby |
| (ppm) | (ppm) | bixafen (ppm) | (ppm) | fluxam (ppm) | Ratio | Efficacy % | expected value % |
| 0.5 | | | | | | 100 | |
| 0.1 | | | | | | 38 | |
| 0.020 | | | | | | 0 | |
| 0.004 | | | | | | 0 | |
| | 4 | | | | | 100 | |
| | 0.8 | | | | | 78 | |
| | 0.16 | | | | | 0 | |
| | | 1.0 | | | | 67 | |
| | | 0.2 | | | | 55 | |
| | | 0.04 | | | | 42 | |
| | | | 20 | | | 100 | |
| | | | 4 | | | 64 | |
| | | | 0.8 | | | 66 | |
| | | | 0.16 | | | 6 | |
| | | | | 1.0 | | 63 | |
| | | | | 0.2 | | 60 | |
| | | | | 0.04 | | 48 | |
| | | | | 0.008 | | 0 | |
| 0.5 | 4 | | | | 1:8 | 100 | 100 |
| 0.5 | 0.8 | | | | 1:1.6 | 100 | 96 |
| 0.5 | 0.16 | | | | 1:0.32 | 93 | 81 |
| 0.1 | 4 | | | | 1:40 | 100 | 100 |
| 0.1 | 0.8 | | | | 1:8 | 98 | 85 |
| 0.1 | 0.16 | | | | 1:1.6 | 87 | 31 |
| 0.020 | 4 | | | | 1:200 | 100 | 100 |
| 0.020 | 0.8 | | | | 1:40 | 100 | 81 |
| 0.020 | 0.16 | | | | 1:8 | 67 | 14 |
| 0.5 | | 1.0 | | | 1:2 | 100 | 94 |
| 0.5 | | 0.2 | | | 1:0.4 | 100 | 91 |
| 0.5 | | 0.04 | | | 1:0.08 | 100 | 89 |
| 0.5 | | | 20 | | 1:40 | 100 | 100 |
| 0.5 | | | 4 | | 1:8 | 100 | 93 |
| 0.5 | | | 0.8 | | 1:1.6 | 100 | 93 |
| 0.5 | | | 0.16 | | 1:0.32 | 100 | 82 |
| 0.5 | | | | 1.0 | 1:2 | 100 | 93 |
| 0.5 | | | | 0.2 | 1:0.4 | 100 | 92 |
| 0.5 | | | | 0.04 | 1:0.08 | 99 | 90 |
| 0.5 | | | | 0.008 | 1:0.016 | 100 | 81 |
| 0.020 | | | | 1.0 | 1:50 | 77 | 68 |
| 0.020 | | | | 0.2 | 1:10 | 70 | 66 |
| 0.020 | | | | 0.04 | 1:2 | 50 | 55 |
| 0.020 | | | | 0.008 | 1:0.4 | 12 | 14 |

TABLE B6
in vitro-Test with Botrytis cinerea

| | (2.038) | (3.025) | (3.020) | | | | |
|---|---|---|---|---|---|---|---|
| | isoflu- | fenpi- | trifloxy- | (1.002) | | | |
| (1-746) | cypram | coxamid | strobin | difenoconazole | | | |
| (ppm) | (ppm) | (ppm) | (ppm) | (ppm) | Ratio | Efficacy % | Colby expected value % |
| 0.5 | | | | | | 100 | |
| 0.1 | | | | | | 38 | |
| 0.020 | | | | | | 0 | |
| 0.004 | | | | | | 0 | |
| | 1.0 | | | | | 83 | |
| | 0.2 | | | | | 63 | |
| | 0.04 | | | | | 43 | |
| | 0.008 | | | | | 0 | |
| | | 5.0 | | | | 34 | |
| | | 1.0 | | | | 0 | |
| | | 0.2 | | | | 13 | |
| | | 0.04 | | | | 0 | |
| | | | 1.0 | | | 14 | |
| | | | 0.2 | | | 3 | |
| | | | 0.04 | | | 0 | |
| | | | 0.008 | | | 0 | |
| | | | | 1.0 | | 0 | |
| | | | | 0.2 | | 0 | |
| | | | | 0.04 | | 0 | |
| 0.5 | 1.0 | | | | 1:2 | 100 | 98 |
| 0.5 | 0.2 | | | | 1:0.4 | 100 | 95 |
| 0.5 | 0.04 | | | | 1:0.08 | 100 | 92 |
| 0.5 | 0.008 | | | | 1:0.016 | 100 | 87 |
| 0.020 | 1.0 | | | | 1:50 | 87 | 83 |
| 0.020 | 0.2 | | | | 1:10 | 72 | 63 |
| 0.020 | 0.04 | | | | 1:2 | 56 | 43 |
| 0.020 | 0.008 | | | | 1:0.4 | 19 | 0 |
| 0.5 | | 5.0 | | | 1:10 | 96 | 91 |
| 0.5 | | 1.0 | | | 1:2 | 100 | 87 |
| 0.5 | | 0.2 | | | 1:0.4 | 100 | 88 |
| 0.5 | | 0.04 | | | 1:0.08 | 100 | 87 |
| 0.5 | | | 1.0 | | 1:2 | 100 | 88 |
| 0.5 | | | 0.2 | | 1:0.4 | 100 | 87 |
| 0.5 | | | 0.04 | | 1:0.08 | 100 | 87 |
| 0.5 | | | 0.008 | | 1:0.016 | 100 | 87 |
| 0.5 | | | | 1.0 | 1:2 | 100 | 87 |
| 0.5 | | | | 0.2 | 1:0.4 | 100 | 87 |
| 0.5 | | | | 0.04 | 1:0.08 | 100 | 87 |
| 0.020 | | | | 1.0 | 1:50 | 15 | 0 |
| 0.020 | | | | 0.2 | 1:10 | 0 | 0 |
| 0.020 | | | | 0.04 | 1:2 | 1 | 0 |
| 0.004 | | | | 1.0 | 1:250 | 5 | 0 |
| 0.004 | | | | 0.2 | 1:50 | 0 | 0 |
| 0.004 | | | | 0.04 | 1:10 | 0 | 0 |

TABLE B7
in vitro-Test with Botrytis cinerea

| | (1.055) | | | | | | |
|---|---|---|---|---|---|---|---|
| | mefen- | (1.018) | (1.021) | (1.020) | | | |
| | triflu- | prothio- | tebu- | spiro- | | | |
| (1-746) | conazole | conazole | conazole | xamine | | | |
| (ppm) | (ppm) | (ppm) | (ppm) | (ppm) | Ratio | Efficacy % | Colby expected value % |
| 0.5 | | | | | | 100 | |
| 0.1 | | | | | | 38 | |
| 0.020 | | | | | | 0 | |
| 0.004 | | | | | | 0 | |
| | 1.0 | | | | | 100 | |
| | 0.2 | | | | | 60 | |
| | 0.04 | | | | | 9 | |
| | | 1.0 | | | | 100 | |
| | | 0.2 | | | | 100 | |
| | | 0.04 | | | | 63 | |
| | | | 1.0 | | | 100 | |
| | | | 0.04 | | | 0 | |
| | | | 0.008 | | | 0 | |
| | | | | 20 | | 15 | |
| | | | | 0.8 | | 0 | |
| | | | | 0.16 | | 1 | |
| 0.1 | 1.0 | | | | 1:10 | 100 | 100 |
| 0.1 | 0.2 | | | | 1:2 | 99 | 69 |
| 0.1 | 0.04 | | | | 1:0.4 | 36 | 30 |
| 0.004 | 1.0 | | | | 1:250 | 99 | 100 |
| 0.004 | 0.2 | | | | 1:50 | 75 | 60 |
| 0.004 | 0.04 | | | | 1:10 | 15 | 9 |
| 0.1 | | 1.0 | | | 1:10 | 100 | 100 |
| 0.1 | | 0.2 | | | 1:2 | 100 | 100 |
| 0.1 | | 0.04 | | | 1:0.4 | 88 | 72 |
| 0.004 | | 1.0 | | | 1:250 | 100 | 100 |
| 0.004 | | 0.2 | | | 1:50 | 100 | 100 |
| 0.004 | | 0.04 | | | 1:10 | 80 | 63 |
| 0.5 | | | 1.0 | | 1:2 | 100 | 100 |
| 0.5 | | | 0.04 | | 1:0.08 | 99 | 88 |
| 0.5 | | | 0.008 | | 1:0.016 | 100 | 88 |
| 0.5 | | | | 20 | 1:40 | 100 | 100 |
| 0.5 | | | | 0.8 | 1:1.6 | 100 | 100 |
| 0.5 | | | | 0.16 | 1:0.32 | 100 | 100 |
| 0.1 | | | | 20 | 1:200 | 46 | 42 |
| 0.1 | | | | 0.8 | 1:8 | 50 | 32 |
| 0.1 | | | | 0.16 | 1:1.6 | 44 | 33 |
| 0.004 | | | | 20 | 1:5000 | 24 | 15 |
| 0.004 | | | | 0.8 | 1:200 | 0 | 0 |
| 0.004 | | | | 0.16 | 1:40 | 0 | 1 |

TABLE B8
in vitro-Test with Botrytis cinerea

| (1-746) | (15.064) | (5.010) | | | | |
|---|---|---|---|---|---|---|
| (ppm) | (ppm) | dithianon (ppm) | (5.012) folpet (ppm) | Ratio | Efficacy % | Colby expected value % |
| 0.5 | | | | | 100 | |
| 0.1 | | | | | 38 | |
| 0.020 | | | | | 0 | |
| 0.004 | | | | | 0 | |
| | 5.0 | | | | 100 | |
| | 1.0 | | | | 100 | |
| | 0.2 | | | | 100 | |
| | 0.04 | | | | 0 | |
| | | 20 | | | 100 | |
| | | 4 | | | 64 | |
| | | | 10 | | 100 | |
| | | | 2 | | 100 | |
| | | | 0.4 | | 0 | |
| | | | 0.08 | | 0 | |
| 0.5 | 0.04 | | | 1:0.08 | 100 | 100 |
| 0.1 | 0.04 | | | 1:0.4 | 66 | 32 |
| 0.020 | 0.04 | | | 1:2 | 18 | 0 |
| 0.004 | 0.04 | | | 1:10 | 21 | 0 |
| 0.5 | | 20 | | 1:40 | 100 | 100 |
| 0.5 | | 4 | | 1:8 | 100 | 100 |
| 0.1 | | 20 | | 1:200 | 100 | 100 |
| 0.1 | | 4 | | 1:40 | 100 | 85 |
| 0.020 | | 20 | | 1:1000 | 100 | 100 |
| 0.020 | | 4 | | 1:200 | 81 | 64 |
| 0.5 | | | 10 | 1:20 | 100 | 100 |
| 0.5 | | | 2 | 1:4 | 100 | 100 |
| 0.5 | | | 0.4 | 1:0.8 | 100 | 99 |
| 0.5 | | | 0.08 | 1:0.16 | 100 | 99 |
| 0.020 | | | 10 | 1:500 | 100 | 100 |
| 0.020 | | | 2 | 1:100 | 100 | 100 |
| 0.020 | | | 0.4 | 1:20 | 4 | 0 |
| 0.020 | | | 0.08 | 1:4 | 27 | 0 |
| 0.004 | | | 10 | 1:2500 | 100 | 100 |
| 0.004 | | | 2 | 1:500 | 100 | 100 |
| 0.004 | | | 0.4 | 1:100 | 3 | 0 |
| 0.004 | | | 0.08 | 1:20 | 24 | 0 |

TABLE B9
in vitro-Test with Botrytis cinerea

| | | (15.016) | | | | |
|---|---|---|---|---|---|---|
| | (5.013) | metra- | (17.012) | | | |
| (1-746) | mancozeb | fenone | paenibacillus | | | |
| (ppm) | (ppm) | (ppm) | terrae (ppm) | Ratio | Efficacy % | Colby expected value % |
| 0.5 | | | | | 100 | |
| 0.1 | | | | | 38 | |
| 0.020 | | | | | 0 | |
| 0.004 | | | | | 0 | |
| | 10 | | | | 19 | |
| | 2 | | | | 2 | |
| | 0.4 | | | | 0 | |
| | | 20 | | | 0 | |
| | | 4 | | | 0 | |
| | | 0.8 | | | 0 | |
| | | | 200 | | 100 | |
| | | | 40 | | 0 | |
| | | | 8 | | 1 | |
| | | | 1.6 | | 0 | |
| 0.5 | 10 | | | 1:20 | 100 | 100 |
| 0.5 | 2 | | | 1:4 | 100 | 100 |
| 0.5 | 0.4 | | | 1:0.8 | 100 | 100 |
| 0.1 | 10 | | | 1:100 | 75 | 38 |
| 0.1 | 2 | | | 1:20 | 26 | 24 |
| 0.1 | 0.4 | | | 1:4 | 67 | 23 |
| 0.020 | 10 | | | 20 | 19 | 20 |
| 0.020 | 2 | | | 0 | 2 | 0 |
| 0.020 | 0.4 | | | 11 | 0 | 11 |
| 0.5 | | 20 | | 1:40 | 100 | 100 |
| 0.5 | | 4 | | 1:8 | 100 | 100 |
| 0.5 | | 0.8 | | 1:1.6 | 100 | 100 |
| 0.1 | | 20 | | 1:200 | 21 | 23 |
| 0.1 | | 4 | | 1:40 | 38 | 23 |
| 0.1 | | 0.8 | | 1:8 | 67 | 23 |
| 0.020 | | 20 | | 1:1000 | 0 | 0 |
| 0.020 | | 4 | | 1:200 | 0 | 0 |
| 0.020 | | 0.8 | | 1:40 | 13 | 0 |
| 0.1 | | | 200 | 1:2000 | 100 | 100 |
| 0.1 | | | 40 | 1:400 | 72 | 38 |
| 0.1 | | | 8 | 1:80 | 34 | 38 |
| 0.1 | | | 1.6 | 1:16 | 49 | 38 |
| 0.004 | | | 200 | 1:50000 | 100 | 100 |
| 0.004 | | | 40 | 1:10000 | 9 | 0 |
| 0.004 | | | 8 | 1:2000 | 0 | 1 |
| 0.004 | | | 1.6 | 1:400 | 15 | 0 |

TABLE BIO
in vitro-Test with Botrytis cinerea

| | (7.005) | (2.002) | (2.028) | | | |
|---|---|---|---|---|---|---|
| (1-749) | pyrimethanil | bixafen | inpyrfluxam | | | |
| (ppm) | (ppm) | (ppm) | (ppm) | Ratio | Efficacy % | Colby expected value % |
| 0.5 | | | | | 99 | |
| 0.1 | | | | | 45 | |
| 0.020 | | | | | 0 | |
| 0.004 | | | | | 0 | |
| | 20 | | | | 100 | |
| | 0.8 | | | | 100 | |
| | 0.16 | | | | 38 | |
| | | 1.0 | | | 73 | |
| | | 0.2 | | | 67 | |
| | | 0.008 | | | 9 | |
| | | | 1.0 | | 91 | |
| | | | 0.2 | | 66 | |
| | | | 0.04 | | 55 | |
| | | | 0.008 | | 0 | |
| 0.1 | 20 | | | 1:200 | 100 | 100 |
| 0.1 | 0.8 | | | 1:8 | 100 | 100 |
| 0.1 | 0.16 | | | 1:1.6 | 75 | 66 |
| 0.020 | 20 | | | 1:1000 | 100 | 100 |
| 0.020 | 0.8 | | | 1:40 | 100 | 100 |
| 0.020 | 0.16 | | | 1:8 | 78 | 38 |
| 0.004 | 20 | | | 1:5000 | 100 | 100 |
| 0.004 | 0.8 | | | 1:200 | 100 | 100 |
| 0.004 | 0.16 | | | 1:40 | 82 | 38 |
| 0.5 | | 1.0 | | 1:2 | 100 | 100 |
| 0.5 | | 0.2 | | 1:0.4 | 100 | 100 |
| 0.5 | | 0.008 | | 1:0.016 | 100 | 99 |
| 0.020 | | 1.0 | | 1:50 | 81 | 73 |
| 0.020 | | 0.2 | | 1:10 | 71 | 67 |
| 0.020 | | 0.008 | | 1:0.4 | 14 | 9 |
| 0.5 | | | 1.0 | 1:2 | 100 | 100 |
| 0.5 | | | 0.2 | 1:0.4 | 100 | 100 |
| 0.5 | | | 0.04 | 1:0.08 | 100 | 99 |
| 0.5 | | | 0.008 | 1:0.016 | 100 | 99 |
| 0.020 | | | 1.0 | 1:50 | 91 | 91 |
| 0.020 | | | 0.2 | 1:10 | 74 | 66 |
| 0.020 | | | 0.04 | 1:2 | 58 | 55 |
| 0.020 | | | 0.008 | 1:0.4 | 25 | 0 |
| 0.004 | | | 1.0 | 1:250 | 84 | 91 |
| 0.004 | | | 0.2 | 1:50 | 66 | 66 |
| 0.004 | | | 0.04 | 1:10 | 60 | 55 |
| 0.004 | | | 0.008 | 1:2 | 9 | 0 |

TABLE B11
in vitro-Test with Botrytis cinerea

| | | (1.055) | (1.018) | | | |
|---|---|---|---|---|---|---|
| | (2.038) | mefentriflu- | prothio- | | | |
| (1-749) | isoflucypram | conazole | conazole | | | |
| (ppm) | (ppm) | (ppm) | (ppm) | Ratio | Efficacy % | Colby expected value % |
| 0.5 | | | | | 99 | |
| 0.1 | | | | | 45 | |
| 0.020 | | | | | 0 | |
| 0.004 | | | | | 0 | |
| | 1.0 | | | | 87 | |
| | 0.2 | | | | 75 | |
| | 0.04 | | | | 57 | |
| | 0.008 | | | | 13 | |
| | | 1.0 | | | 100 | |
| | | 0.2 | | | 96 | |
| | | 0.04 | | | 0 | |
| | | 0.008 | | | 0 | |
| | | | 1.0 | | 100 | |
| | | | 0.2 | | 100 | |
| | | | 0.04 | | 43 | |
| | | | 0.008 | | 0 | |
| 0.020 | 1.0 | | | 1:50 | 87 | 87 |
| 0.020 | 0.2 | | | 1:10 | 74 | 75 |
| 0.020 | 0.04 | | | 1:2 | 61 | 58 |
| 0.020 | 0.008 | | | 1:0.4 | 19 | 15 |
| 0.1 | | 1.0 | | 1:10 | 99 | 100 |
| 0.1 | | 0.2 | | 1:2 | 98 | 96 |
| 0.1 | | 0.04 | | 1:0.4 | 25 | 0 |
| 0.1 | | 0.008 | | 1:0.08 | 0 | 0 |
| 0.004 | | 1.0 | | 1:250 | 100 | 100 |
| 0.004 | | 0.2 | | 1:50 | 99 | 96 |
| 0.004 | | 0.04 | | 1:10 | 0 | 0 |
| 0.004 | | 0.008 | | 1:2 | 0 | 0 |
| 0.1 | | | 1.0 | 1:10 | 100 | 100 |
| 0.1 | | | 0.2 | 1:2 | 100 | 100 |
| 0.1 | | | 0.04 | 1:0.4 | 52 | 43 |
| 0.1 | | | 0.008 | 1:0.08 | 0 | 0 |
| 0.004 | | | 1.0 | 1:250 | 100 | 100 |
| 0.004 | | | 0.2 | 1:50 | 100 | 100 |
| 0.004 | | | 0.04 | 1:10 | 60 | 43 |
| 0.004 | | | 0.008 | 1:2 | 1 | 0 |

TABLE B12
in vitro-Test with Botrytis cinerea

| | (1.021) | (5.003) | (5.012) | | | |
|---|---|---|---|---|---|---|
| (1-749) | tebuconazole | captan | folpet | | | |
| (ppm) | (ppm) | (ppm) | (ppm) | Ratio | Efficacy % | Colby expected value % |
| 0.5 | | | | | 99 | |
| 0.1 | | | | | 45 | |
| 0.020 | | | | | 0 | |
| 0.004 | | | | | 0 | |
| | 0.2 | | | | 39 | |
| | 0.04 | | | | 5 | |
| | 0.008 | | | | 2 | |
| | | 20 | | | 100 | |
| | | 4 | | | 20 | |
| | | | 2 | | 100 | |
| | | | 0.4 | | 2 | |
| | | | 0.08 | | 0 | |
| 0.1 | 0.2 | | | 1:2 | 78 | 39 |
| 0.1 | 0.04 | | | 1:0.4 | 0 | 5 |
| 0.1 | 0.008 | | | 1:0.08 | 0 | 2 |
| 0.020 | 0.2 | | | 1:10 | 52 | 39 |
| 0.020 | 0.04 | | | 1:2 | 0 | 5 |
| 0.020 | 0.008 | | | 1:0.4 | 4 | 2 |
| 0.004 | 0.2 | | | 1:50 | 46 | 39 |
| 0.004 | 0.04 | | | 1:10 | 0 | 5 |
| 0.004 | 0.008 | | | 1:2 | 3 | 2 |
| 0.1 | | 20 | | 1:200 | 100 | 100 |
| 0.1 | | 4 | | 1:40 | 100 | 61 |
| 0.020 | | 20 | | 1:1000 | 99 | 100 |
| 0.020 | | 4 | | 1:200 | 88 | 20 |
| 0.004 | | 20 | | 1:5000 | 100 | 100 |
| 0.004 | | 4 | | 1:1000 | 84 | 24 |
| 0.5 | | | 2 | 1:4 | 100 | 100 |
| 0.5 | | | 0.4 | 1:0.8 | 99 | 95 |
| 0.5 | | | 0.08 | 1:0.16 | 99 | 95 |
| 0.020 | | | 2 | 1:100 | 99 | 100 |
| 0.020 | | | 0.4 | 1:20 | 11 | 2 |
| 0.020 | | | 0.08 | 1:4 | 23 | 0 |

TABLE B13
in vitro-Test with Botrytis cinerea

| | | | (17.012) | | | | |
|---|---|---|---|---|---|---|---|
| | | (17.001) | Paeni- | | | | |
| | (6.002) | Bacillus | bacillus | (18.001) | | | |
| (1-749) | isotianil | subtilis | terrae | FLiPPER | | | |
| (ppm) | (ppm) | (ppm) | (ppm) | (ppm) | Ratio | Efficacy % | Colby expected value % |
| 0.5 | | | | | | 99 | |
| 0.1 | | | | | | 45 | |
| 0.020 | | | | | | 0 | |
| 0.004 | | | | | | 0 | |
| | 100 | | | | | 0 | |
| | 20 | | | | | 0 | |
| | 4 | | | | | 0 | |
| | 0.8 | | | | | 11 | |
| | | 8 | | | | 3 | |
| | | 1.6 | | | | 9 | |
| | | | 200 | | | 100 | |
| | | | 40 | | | 29 | |
| | | | 8 | | | 5 | |
| | | | | 40 | | 0 | |
| | | | | 8 | | 0 | |
| | | | | 1.6 | | 0 | |
| 0.5 | 100 | | | | 1:200 | 100 | 95 |
| 0.5 | 20 | | | | 1:40 | 100 | 95 |
| 0.5 | 4 | | | | 1:8 | 100 | 95 |
| 0.5 | 0.8 | | | | 1:1.6 | 100 | 96 |
| 0.5 | | 8 | | | 1:16 | 100 | 95 |
| 0.5 | | 1.6 | | | 1:3.2 | 100 | 95 |
| 0.004 | | 8 | | | 1:2000 | 11 | 3 |
| 0.004 | | 1.6 | | | 1:400 | 0 | 9 |
| 0.5 | | | 200 | | 1:400 | 100 | 100 |
| 0.5 | | | 40 | | 1:80 | 100 | 97 |
| 0.5 | | | 8 | | 1:16 | 100 | 95 |
| 0.1 | | | 200 | | 1:2000 | 100 | 100 |
| 0.1 | | | 40 | | 1:400 | 54 | 42 |
| 0.1 | | | 8 | | 1:80 | 0 | 2 |
| 0.020 | | | 200 | | 1:10000 | 100 | 100 |
| 0.020 | | | 40 | | 1:2000 | 37 | 29 |
| 0.020 | | | 8 | | 1:400 | 4 | 5 |
| 0.5 | | | | 40 | 1:80 | 95 | 95 |
| 0.5 | | | | 8 | 1:16 | 100 | 95 |
| 0.5 | | | | 1.6 | 1:3.2 | 100 | 95 |

TABLE Cl
in vitro-Test with Cercospora beticola

| | (7.005) | (2.005) | (2.038) | | | |
|---|---|---|---|---|---|---|
| (1-655) | pyrimethanil | fluopyram | isoflucypram | | | |
| (ppm) | (ppm) | (ppm) | (ppm) | Ratio | Efficacy % | Colby expected value % |
| 0.5 | | | | | 7 | |
| 0.1 | | | | | 0 | |
| 0.020 | | | | | 0 | |
| 0.004 | | | | | 0 | |
| | 20 | | | | 100 | |
| | 4 | | | | 7 | |
| | 0.8 | | | | 0 | |
| | 0.16 | | | | 0 | |
| | | 20 | | | 17 | |
| | | 0.16 | | | 0 | |
| | | | 1.0 | | 35 | |
| | | | 0.008 | | 11 | |
| 0.5 | 20 | | | 1:40 | 100 | 100 |
| 0.5 | 4 | | | 1:8 | 70 | 7 |
| 0.1 | 20 | | | 1:200 | 100 | 100 |
| 0.1 | 4 | | | 1:40 | 55 | 26 |
| 0.020 | 20 | | | 1:1000 | 100 | 100 |
| 0.020 | 4 | | | 1:200 | 35 | 19 |
| 0.004 | 20 | | | 1:5000 | 100 | 100 |
| 0.004 | 4 | | | 1:1000 | 0 | 11 |
| 0.5 | | 20 | | 1:40 | 64 | 17 |
| 0.5 | | 0.16 | | 1:0.32 | 2 | 0 |
| 0.1 | | 20 | | 1:200 | 39 | 34 |
| 0.1 | | 0.16 | | 1:1.6 | 26 | 21 |
| 0.020 | | 20 | | 1:1000 | 35 | 28 |
| 0.020 | | 0.16 | | 1:8 | 0 | 13 |
| 0.004 | | 20 | | 1:5000 | 63 | 27 |
| 0.004 | | 0.16 | | 1:40 | 23 | 11 |
| 0.5 | | | 1.0 | 1:2 | 67 | 35 |
| 0.5 | | | 0.008 | 1:0.016 | 0 | 11 |
| 0.1 | | | 1.0 | 1:10 | 60 | 35 |
| 0.1 | | | 0.008 | 1:0.08 | 13 | 11 |
| 0.020 | | | 1.0 | 1:50 | 46 | 35 |
| 0.020 | | | 0.008 | 1:0.4 | 17 | 11 |
| 0.004 | | | 1.0 | 1:250 | 72 | 42 |
| 0.004 | | | 0.008 | 1:2 | 21 | 21 |

TABLE C2
in vitro-Test with Cercospora beticola

| | (3.025) | (1.002) | (1.055) | | | |
|---|---|---|---|---|---|---|
| | fenpi- | difeno- | mefentriflu- | | | |
| (1-655) | coxamid | conazole | conazole | | | |
| (ppm) | (ppm) | (ppm) | (ppm) | Ratio | Efficacy % | Colby expected value % |
| 0.5 | | | | | 7 | |
| 0.1 | | | | | 0 | |
| 0.020 | | | | | 0 | |
| 0.004 | | | | | 0 | |
| | 5.0 | | | | 86 | |
| | 1.0 | | | | 74 | |
| | 0.2 | | | | 22 | |
| | | 1.0 | | | 100 | |
| | | 0.2 | | | 68 | |
| | | 0.04 | | | 41 | |
| | | | 0.2 | | 100 | |
| | | | 0.04 | | 100 | |
| | | | 0.008 | | 42 | |
| 0.5 | 5.0 | | | 1:10 | 99 | 86 |
| 0.5 | 1.0 | | | 1:2 | 98 | 74 |
| 0.5 | 0.2 | | | 1:0.4 | 84 | 22 |
| 0.1 | 5.0 | | | 1:50 | 100 | 86 |
| 0.1 | 1.0 | | | 1:10 | 78 | 74 |
| 0.1 | 0.2 | | | 1:2 | 30 | 22 |
| 0.5 | | 1.0 | | 1:2 | 100 | 100 |
| 0.5 | | 0.2 | | 1:0.4 | 98 | 68 |
| 0.5 | | 0.04 | | 1:0.08 | 52 | 41 |
| 0.1 | | 1.0 | | 1:10 | 100 | 100 |
| 0.1 | | 0.2 | | 1:2 | 84 | 68 |
| 0.1 | | 0.04 | | 1:0.4 | 70 | 41 |
| 0.020 | | 1.0 | | 1:50 | 100 | 100 |
| 0.020 | | 0.2 | | 1:10 | 74 | 68 |
| 0.020 | | 0.04 | | 1:2 | 40 | 41 |
| 0.5 | | | 0.2 | 1:0.4 | 100 | 100 |
| 0.5 | | | 0.04 | 1:0.08 | 100 | 100 |
| 0.5 | | | 0.008 | 1:0.016 | 86 | 42 |
| 0.1 | | | 0.2 | 1:2 | 100 | 100 |
| 0.1 | | | 0.04 | 1:0.4 | 100 | 100 |
| 0.1 | | | 0.008 | 1:0.08 | 67 | 42 |
| 0.020 | | | 0.2 | 1:10 | 100 | 100 |
| 0.020 | | | 0.04 | 1:2 | 100 | 100 |
| 0.020 | | | 0.008 | 1:0.4 | 55 | 42 |

TABLE C3
in vitro-Test with Cercospora beticola

| | (1.018) | (1.021) | | (17.001) | | | |
|---|---|---|---|---|---|---|---|
| | prothio- | tebu- | (5.003) | Bacillus | | | |
| (1-655) | conazole | conazole | captan | subtilis | | | |
| (ppm) | (ppm) | (ppm) | (ppm) | (ppm) | Ratio | Efficacy % | Colby expected value % |
| 0.5 | | | | | | 7 | |
| 0.1 | | | | | | 0 | |
| 0.020 | | | | | | 0 | |
| 0.004 | | | | | | 0 | |
| | 0.2 | | | | | 100 | |
| | 0.04 | | | | | 88 | |
| | 0.008 | | | | | 0 | |
| | | 0.2 | | | | 83 | |
| | | 0.04 | | | | 22 | |
| | | 0.008 | | | | 0 | |
| | | | 20 | | | 100 | |
| | | | 4 | | | 73 | |
| | | | 0.8 | | | 0 | |
| | | | 0.16 | | | 5 | |
| | | | | 200 | | 0 | |
| | | | | 40 | | 0 | |
| | | | | 8 | | 19 | |
| 0.5 | 0.2 | | | | 1:0.4 | 100 | 100 |
| 0.5 | 0.04 | | | | 1:0.08 | 100 | 88 |
| 0.5 | 0.008 | | | | 1:0.016 | 29 | 0 |
| 0.1 | 0.2 | | | | 1:2 | 100 | 100 |
| 0.1 | 0.04 | | | | 1:0.4 | 88 | 88 |
| 0.1 | 0.008 | | | | 1:0.08 | 45 | 0 |
| 0.020 | 0.2 | | | | 1:10 | 100 | 100 |
| 0.020 | 0.04 | | | | 1:2 | 89 | 88 |
| 0.020 | 0.008 | | | | 1:0.4 | 0 | 0 |
| 0.004 | 0.2 | | | | 1:50 | 100 | 100 |
| 0.004 | 0.04 | | | | 1:10 | 84 | 88 |
| 0.004 | 0.008 | | | | 1:2 | 38 | 0 |
| 0.5 | | 0.2 | | | 1:0.4 | 86 | 83 |
| 0.5 | | 0.04 | | | 1:0.08 | 29 | 22 |
| 0.5 | | 0.008 | | | 1:0.016 | 5 | 0 |
| 0.1 | | 0.2 | | | 1:2 | 82 | 83 |
| 0.1 | | 0.04 | | | 1:0.4 | 40 | 22 |
| 0.1 | | 0.008 | | | 1:0.08 | 0 | 0 |
| 0.020 | | 0.2 | | | 1:10 | 93 | 83 |
| 0.020 | | 0.04 | | | 1:2 | 27 | 22 |
| 0.020 | | 0.008 | | | 1:0.4 | 0 | 0 |
| 0.5 | | | 20 | | 1:40 | 100 | 100 |
| 0.5 | | | 4 | | 1:8 | 100 | 73 |
| 0.5 | | | 0.8 | | 1:1.6 | 41 | 0 |
| 0.5 | | | 0.16 | | 1:0.32 | 20 | 5 |
| 0.1 | | | 20 | | 1:200 | 100 | 100 |
| 0.1 | | | 4 | | 1:40 | 76 | 73 |
| 0.1 | | | 0.8 | | 1:8 | 58 | 0 |
| 0.1 | | | 0.16 | | 1:1.6 | 52 | 5 |
| 0.020 | | | 20 | | 1:1000 | 100 | 100 |
| 0.020 | | | 4 | | 1:200 | 64 | 73 |
| 0.020 | | | 0.8 | | 1:40 | 25 | 0 |
| 0.020 | | | 0.16 | | 1:8 | 54 | 5 |
| 0.004 | | | 20 | | 1:5000 | 100 | 100 |
| 0.004 | | | 4 | | 1:1000 | 100 | 75 |
| 0.004 | | | 0.8 | | 1:200 | 35 | 6 |
| 0.004 | | | 0.16 | | 1:40 | 41 | 11 |
| 0.5 | | | | 200 | 1:400 | 66 | 0 |
| 0.5 | | | | 40 | 1:80 | 0 | 0 |
| 0.5 | | | | 8 | 1:16 | 23 | 19 |

TABLE C4
in vitro-Test with Cercospora beticola

| | (2.038) | (3.025) | (3.020) | | | |
|---|---|---|---|---|---|---|
| | isoflu- | fenpi- | trifloxy- | | | Colby |
| (I-746) | cypram | coxamid | strobin | | Efficacy | expected |
| (ppm) | (ppm) | (ppm) | (ppm) | Ratio | % | value % |
| 0.5 | | | | | 26 | |
| 0.1 | | | | | 4 | |
| 0.020 | | | | | 5 | |
| 0.004 | | | | | 0 | |
| | 1.0 | | | | 39 | |
| | 0.04 | | | | 16 | |
| | | 5.0 | | | 78 | |
| | | 1.0 | | | 58 | |
| | | 0.2 | | | 0 | |
| | | 0.04 | | | 16 | |
| | | | 1.0 | | 100 | |
| | | | 0.2 | | 95 | |
| | | | 0.04 | | 100 | |
| | | | 0.008 | | 98 | |
| 0.5 | 1.0 | | | 1:2 | 70 | 39 |
| 0.5 | 0.04 | | | 1:0.08 | 26 | 16 |
| 0.1 | 1.0 | | | 1:10 | 63 | 46 |
| 0.1 | 0.04 | | | 1:0.4 | 34 | 25 |
| 0.020 | 1.0 | | | 1:50 | 60 | 40 |
| 0.020 | 0.04 | | | 1:2 | 0 | 8 |
| 0.5 | | 5.0 | | 1:10 | 100 | 78 |
| 0.5 | | 1.0 | | 1:2 | 89 | 58 |
| 0.5 | | 0.2 | | 1:0.4 | 25 | 0 |
| 0.5 | | 0.04 | | 1:0.08 | 51 | 16 |
| 0.5 | | | 1.0 | 1:2 | 100 | 100 |
| 0.5 | | | 0.2 | 1:0.4 | 100 | 95 |
| 0.5 | | | 0.04 | 1:0.08 | 100 | 100 |
| 0.5 | | | 0.008 | 1:0.016 | 100 | 98 |
| 0.1 | | | 1.0 | 1:10 | 100 | 100 |
| 0.1 | | | 0.2 | 1:2 | 100 | 96 |
| 0.1 | | | 0.04 | 1:0.4 | 100 | 100 |
| 0.1 | | | 0.008 | 1:0.08 | 97 | 98 |
| 0.020 | | | 1.0 | 1:50 | 99 | 100 |
| 0.020 | | | 0.2 | 1:10 | 100 | 95 |
| 0.020 | | | 0.04 | 1:2 | 100 | 100 |
| 0.020 | | | 0.008 | 1:0.4 | 97 | 98 |
| 0.004 | | | 1.0 | 1:250 | 100 | 100 |
| 0.004 | | | 0.2 | 1:50 | 100 | 96 |
| 0.004 | | | 0.04 | 1:10 | 100 | 100 |
| 0.004 | | | 0.008 | 1:2 | 100 | 99 |

TABLE C5
in vitro-Test with Cercospora beticola

| | | (1.055) | | | | | Colby |
|---|---|---|---|---|---|---|---|
| | (1.002) | mefentri- | (1.021) | (13.001) | | | ex- |
| | difeno- | flucon- | tebu- | fludio- | | Effi- | pected |
| (I-746) | conazole | azole | conazole | xonil | | cacy | value |
| (ppm) | (ppm) | (ppm) | (ppm) | (ppm) | Ratio | % | % |
| 0.5 | | | | | | 26 | |
| 0.1 | | | | | | 4 | |
| 0.020 | | | | | | 5 | |
| 0.004 | | | | | | 0 | |
| | 1.0 | | | | | 100 | |
| | 0.2 | | | | | 87 | |
| | 0.04 | | | | | 20 | |
| | | 0.2 | | | | 100 | |
| | | 0.04 | | | | 100 | |
| | | 0.008 | | | | 15 | |
| | | | 1.0 | | | 100 | |
| | | | 0.2 | | | 93 | |
| | | | 0.04 | | | 11 | |
| | | | | 5.0 | | 95 | |
| | | | | 1.0 | | 80 | |
| 0.5 | 1.0 | | | | 1:2 | 99 | 100 |
| 0.5 | 0.2 | | | | 1:0.4 | 100 | 87 |
| 0.5 | 0.04 | | | | 1:0.08 | 64 | 20 |
| 0.1 | 1.0 | | | | 1:10 | 99 | 100 |
| 0.1 | 0.2 | | | | 1:2 | 92 | 88 |
| 0.1 | 0.04 | | | | 1:0.4 | 51 | 29 |
| 0.020 | 1.0 | | | | 1:50 | 100 | 100 |
| 0.020 | 0.2 | | | | 1:10 | 89 | 87 |
| 0.020 | 0.04 | | | | 1:2 | 43 | 22 |
| 0.004 | 1.0 | | | | 1:250 | 100 | 100 |
| 0.004 | 0.2 | | | | 1:50 | 89 | 90 |
| 0.004 | 0.04 | | | | 1:10 | 50 | 41 |
| 0.5 | | 0.2 | | | 1:0.4 | 100 | 100 |
| 0.5 | | 0.04 | | | 1:0.08 | 100 | 100 |
| 0.5 | | 0.008 | | | 1:0.016 | 78 | 15 |
| 0.1 | | 0.2 | | | 1:2 | 100 | 100 |
| 0.1 | | 0.04 | | | 1:0.4 | 100 | 100 |
| 0.1 | | 0.008 | | | 1:0.08 | 73 | 32 |
| 0.020 | | 0.2 | | | 1:10 | 100 | 100 |
| 0.020 | | 0.04 | | | 1:2 | 100 | 100 |
| 0.020 | | 0.008 | | | 1:0.4 | 58 | 36 |
| 0.004 | | 0.2 | | | 1:50 | 100 | 100 |
| 0.004 | | 0.04 | | | 1:10 | 100 | 100 |
| 0.004 | | 0.008 | | | 1:2 | 48 | 23 |
| 0.5 | | | 1.0 | | 1:2 | 99 | 100 |
| 0.5 | | | 0.2 | | 1:0.4 | 94 | 93 |
| 0.5 | | | 0.04 | | 1:0.08 | 36 | 11 |
| 0.020 | | | 1.0 | | 1:50 | 100 | 100 |
| 0.020 | | | 0.2 | | 1:10 | 100 | 95 |
| 0.020 | | | 0.04 | | 1:2 | 48 | 33 |
| 0.004 | | | 1.0 | | 1:250 | 100 | 100 |
| 0.004 | | | 0.2 | | 1:50 | 99 | 94 |
| 0.004 | | | 0.04 | | 1:10 | 22 | 19 |
| 0.5 | | | | 5.0 | 1:10 | 96 | 95 |
| 0.5 | | | | 1.0 | 1:2 | 87 | 80 |
| 0.1 | | | | 5.0 | 1:50 | 100 | 95 |
| 0.1 | | | | 1.0 | 1:10 | 95 | 80 |
| 0.020 | | | | 5.0 | 1:250 | 100 | 96 |
| 0.020 | | | | 1.0 | 1:50 | 85 | 83 |
| 0.004 | | | | 5.0 | 1:1250 | 100 | 96 |
| 0.004 | | | | 1.0 | 1:250 | 92 | 84 |

TABLE C6
in vitro-Test with Cercospora beticola

| | (13.005) | (5.010) | (5.012) | | | Colby |
|---|---|---|---|---|---|---|
| (I-746) | quinoxyfen | dithianon | folpet | | Efficacy | expected |
| (ppm) | (ppm) | (ppm) | (ppm) | Ratio | % | value % |
| 0.5 | | | | | 26 | |
| 0.1 | | | | | 4 | |
| 0.020 | | | | | 5 | |
| 0.004 | | | | | 0 | |
| | 10 | | | | 20 | |
| | 0.4 | | | | 2 | |
| | 0.080 | | | | 0 | |
| | | 20 | | | 98 | |
| | | 4 | | | 99 | |
| | | 0.8 | | | 6 | |
| | | 0.16 | | | 0 | |
| | | | 10 | | 100 | |
| | | | 2 | | 100 | |
| | | | 0.4 | | 29 | |
| | | | 0.08 | | 7 | |
| 0.1 | 10 | | | 1:100 | 17 | 23 |
| 0.1 | 0.4 | | | 1:4 | 29 | 6 |
| 0.1 | 0.080 | | | 1:0.8 | 24 | 4 |
| 0.020 | 10 | | | 1:500 | 19 | 24 |
| 0.020 | 0.4 | | | 1:20 | 10 | 7 |
| 0.020 | 0.080 | | | 1:4 | 43 | 5 |
| 0.004 | 10 | | | 1:2500 | 22 | 20 |
| 0.004 | 0.4 | | | 1:100 | 21 | 2 |
| 0.004 | 0.080 | | | 1:20 | 29 | 0 |
| 0.5 | | 20 | | 1:40 | 100 | 99 |
| 0.5 | | 4 | | 1:8 | 100 | 100 |
| 0.5 | | 0.8 | | 1:1.6 | 61 | 31 |
| 0.5 | | 0.16 | | 1:0.32 | 40 | 26 |
| 0.004 | | 20 | | 1:5000 | 99 | 98 |
| 0.004 | | 4 | | 1:1000 | 100 | 99 |
| 0.004 | | 0.8 | | 1:200 | 0 | 6 |
| 0.004 | | 0.16 | | 1:40 | 20 | 0 |
| 0.5 | | | 10 | 1:20 | 99 | 100 |
| 0.5 | | | 2 | 1:4 | 99 | 100 |
| 0.5 | | | 0.4 | 1:0.8 | 56 | 48 |
| 0.004 | | | 10 | 1:2500 | 100 | 100 |
| 0.004 | | | 2 | 1:500 | 100 | 100 |
| 0.004 | | | 0.4 | 1:100 | 25 | 29 |
| 0.004 | | | 0.08 | 1:20 | 26 | 7 |

TABLE C7
in vitro -Test with Cercospora beticola

| | (5.013) | (6.002) | | | Colby |
|---|---|---|---|---|---|
| (I-746) | mancozeb | isotianil | | Efficacy | expected |
| (ppm) | (ppm) | (ppm) | Ratio | % | value % |
| 0.5 | | | | 26 | |
| 0.1 | | | | 4 | |
| 0.020 | | | | 5 | |
| 0.004 | | | | 0 | |
| | 10 | | | 100 | |
| | 2 | | | 100 | |
| | 0.4 | | | 0 | |
| | | 100 | | 29 | |
| | | 20 | | 12 | |
| | | 4 | | 17 | |
| | | 0.8 | | 17 | |
| 0.5 | 10 | | 1:20 | 100 | 100 |
| 0.5 | 2 | | 1:4 | 100 | 100 |
| 0.5 | 0.4 | | 1:0.8 | 57 | 26 |
| 0.5 | | 100 | 1:200 | 42 | 29 |
| 0.5 | | 20 | 1:40 | 16 | 12 |
| 0.5 | | 4 | 1:8 | 34 | 17 |
| 0.5 | | 0.8 | 1:1.6 | 14 | 17 |
| 0.020 | | 100 | 1:5000 | 40 | 29 |
| 0.020 | | 20 | 1:1000 | 26 | 12 |
| 0.020 | | 4 | 1:200 | 38 | 17 |
| 0.020 | | 0.8 | 1:40 | 9 | 17 |

TABLE C8
in vitro-Test with Cercospora beticola

| | (7.005) | (3.025) | (1.002) | | | |
|---|---|---|---|---|---|---|
| | pyrime- | fenpi- | difeno- | | | Colby |
| (I-749) | thanil | coxamid | conazole | | Efficacy | expected |
| (ppm) | (ppm) | (ppm) | (ppm) | Ratio | % | value % |
| 0.5 | | | | | 22 | |
| 0.1 | | | | | 8 | |
| 0.020 | | | | | 0 | |
| 0.004 | | | | | 0 | |
| | 20 | | | | 100 | |
| | 4 | | | | 55 | |
| | 0.8 | | | | 0 | |
| | | 1.0 | | | 42 | |
| | | 0.2 | | | 2 | |
| | | 0.04 | | | 0 | |
| | | | 0.2 | | 82 | |
| | | | 0.04 | | 19 | |
| | | | 0.008 | | 9 | |
| 0.1 | 20 | | | 1:200 | 100 | 100 |
| 0.1 | 4 | | | 1:40 | 100 | 55 |
| 0.1 | 0.8 | | | 1:8 | 0 | 0 |
| 0.020 | 20 | | | 1:1000 | 100 | 100 |
| 0.020 | 4 | | | 1:200 | 100 | 55 |
| 0.020 | 0.8 | | | 1:40 | 0 | 0 |
| 0.004 | 20 | | | 1:5000 | 100 | 100 |
| 0.004 | 4 | | | 1:1000 | 100 | 55 |
| 0.004 | 0.8 | | | 1:200 | 7 | 0 |
| 0.5 | | 1.0 | | 1:2 | 86 | 42 |
| 0.5 | | 0.2 | | 1:0.4 | 73 | 3 |
| 0.5 | | 0.04 | | 1:0.08 | 38 | 1 |
| 0.1 | | 1.0 | | 1:10 | 65 | 42 |
| 0.1 | | 0.2 | | 1:2 | 31 | 2 |
| 0.1 | | 0.04 | | 1:0.4 | 28 | 0 |
| 0.004 | | 1.0 | | 1:250 | 75 | 42 |
| 0.004 | | 0.2 | | 1:50 | 0 | 2 |
| 0.004 | | 0.04 | | 1:10 | 15 | 0 |
| 0.5 | | | 0.2 | 1:0.4 | 99 | 82 |
| 0.5 | | | 0.04 | 1:0.08 | 75 | 19 |
| 0.5 | | | 0.008 | 1:0.016 | 27 | 9 |
| 0.1 | | | 0.2 | 1:2 | 91 | 82 |
| 0.1 | | | 0.04 | 1:0.4 | 69 | 19 |
| 0.1 | | | 0.008 | 1:0.08 | 2 | 9 |
| 0.004 | | | 0.2 | 1:50 | 94 | 82 |
| 0.004 | | | 0.04 | 1:10 | 34 | 19 |
| 0.004 | | | 0.008 | 1:2 | 12 | 9 |

TABLE C9
in vitro-Test with Cercospora beticola

| | (1.055) | (1.021) | | | | |
|---|---|---|---|---|---|---|
| | mefentriflu- | tebucon- | | | Effi- | Colby |
| (I-749) | conazole | azole | (15.064) | | cacy | expected |
| (ppm) | (ppm) | (ppm) | (ppm) | Ratio | % | value % |
| 0.5 | | | | | 22 | |
| 0.1 | | | | | 8 | |
| 0.020 | | | | | 0 | |
| 0.004 | | | | | 0 | |
| | 0.2 | | | | 100 | |
| | 0.04 | | | | 100 | |
| | 0.008 | | | | 72 | |
| | | 1.0 | | | 100 | |
| | | 0.2 | | | 96 | |
| | | 0.04 | | | 19 | |
| | | 0.008 | | | 0 | |
| | | | 10 | | 14 | |
| | | | 0.4 | | 0 | |
| | | | 0.080 | | 0 | |
| 0.5 | 0.2 | | | 1:0.4 | 100 | 100 |
| 0.5 | 0.04 | | | 1:0.08 | 100 | 100 |
| 0.5 | 0.008 | | | 1:0.016 | 96 | 78 |
| 0.1 | 0.2 | | | 1:2 | 100 | 100 |
| 0.1 | 0.04 | | | 1:0.4 | 99 | 100 |
| 0.1 | 0.008 | | | 1:0.08 | 96 | 74 |
| 0.5 | | 1.0 | | 1:2 | 99 | 100 |
| 0.5 | | 0.2 | | 1:0.4 | 96 | 97 |
| 0.5 | | 0.008 | | 1:0.016 | 54 | 22 |
| 0.020 | | 1.0 | | 1:50 | 100 | 100 |
| 0.020 | | 0.2 | | 1:10 | 98 | 96 |
| 0.020 | | 0.008 | | 1:0.4 | 0 | 0 |
| 0.004 | | 1.0 | | 1:250 | 100 | 100 |
| 0.004 | | 0.2 | | 1:50 | 99 | 96 |
| 0.004 | | 0.04 | | 1:10 | 44 | 19 |
| 0.004 | | 0.008 | | 1:2 | 0 | 0 |
| 0.1 | | | 10 | 1:100 | 53 | 14 |
| 0.1 | | | 0.4 | 1:4 | 20 | 0 |
| 0.1 | | | 0.080 | 1:0.8 | 25 | 0 |
| 0.004 | | | 10 | 1:2500 | 54 | 14 |
| 0.004 | | | 0.4 | 1:100 | 0 | 0 |
| 0.004 | | | 0.080 | 1:20 | 27 | 0 |

TABLE C10
in vitro-Test with Cercospora beticola

| | (13.001) | (5.010) | (5.012) | | | Colby |
|---|---|---|---|---|---|---|
| (I-749) | fludioxonil | dithianon | folpet | | Efficacy | expected |
| (ppm) | (ppm) | (ppm) | (ppm) | Ratio | % | value % |
| 0.5 | | | | | 22 | |
| 0.1 | | | | | 8 | |
| 0.020 | | | | | 0 | |
| 0.004 | | | | | 0 | |
| | 5.0 | | | | 93 | |
| | 1.0 | | | | 59 | |
| | | 20 | | | 100 | |
| | | 4 | | | 100 | |
| | | 0.8 | | | 0 | |
| | | | 10 | | 100 | |
| | | | 2 | | 100 | |
| | | | 0.4 | | 0 | |
| 0.5 | 5.0 | | | 1:10 | 100 | 95 |
| 0.5 | 1.0 | | | 1:2 | 87 | 67 |
| 0.1 | 5.0 | | | 1:50 | 98 | 93 |
| 0.1 | 1.0 | | | 1:10 | 100 | 59 |
| 0.020 | 5.0 | | | 1:250 | 100 | 93 |
| 0.020 | 1.0 | | | 1:50 | 78 | 59 |
| 0.004 | 5.0 | | | 1:1250 | 90 | 93 |
| 0.004 | 1.0 | | | 1:250 | 61 | 59 |
| 0.5 | | 20 | | 1:40 | 100 | 100 |
| 0.5 | | 4 | | 1:8 | 100 | 100 |
| 0.5 | | 0.8 | | 1:1.6 | 74 | 0 |
| 0.1 | | 20 | | 1:200 | 100 | 100 |
| 0.1 | | 4 | | 1:40 | 100 | 100 |
| 0.1 | | 0.8 | | 1:8 | 17 | 0 |
| 0.020 | | 20 | | 1:1000 | 99 | 100 |
| 0.020 | | 4 | | 1:200 | 100 | 100 |
| 0.020 | | 0.8 | | 1:40 | 0 | 0 |
| 0.5 | | | 10 | 1:20 | 100 | 100 |
| 0.5 | | | 2 | 1:4 | 100 | 100 |
| 0.5 | | | 0.4 | 1:0.8 | 45 | 0 |
| 0.1 | | | 10 | 1:100 | 100 | 100 |
| 0.1 | | | 2 | 1:20 | 99 | 100 |
| 0.1 | | | 0.4 | 1:4 | 27 | 0 |
| 0.020 | | | 10 | 1:500 | 100 | 100 |
| 0.020 | | | 2 | 1:100 | 100 | 100 |
| 0.020 | | | 0.4 | 1:20 | 0 | 0 |

TABLE C11
in vitro-Test with Cercospora beticola

| | | | (15.012) | | (17.012) | | | |
|---|---|---|---|---|---|---|---|---|
| | (5.013) | (5.018) | fosetyl- | (15.016) | Paenibacillus | | | Colby |
| (I-749) | mancozeb | propineb | aluminium | metrafenone | terrae | | | expected |
| (ppm) | (ppm) | (ppm) | (ppm) | (ppm) | (ppm) | Ratio | Efficacy % | value % |
| 0.5 | | | | | | | 22 | |
| 0.1 | | | | | | | 8 | |
| 0.020 | | | | | | | 0 | |
| 0.004 | | | | | | | 0 | |
| | 10 | | | | | | 100 | |
| | 2 | | | | | | 94 | |
| | 0.4 | | | | | | 20 | |
| | 0.080 | | | | | | 13 | |
| | | 100 | | | | | 99 | |
| | | 20 | | | | | 100 | |
| | | 4 | | | | | 100 | |
| | | 0.8 | | | | | 5 | |
| | | | 100 | | | | 15 | |
| | | | 20 | | | | 4 | |
| | | | 4 | | | | 0 | |
| | | | 0.8 | | | | 0 | |
| | | | | 4 | | | 13 | |
| | | | | 0.8 | | | 0 | |
| | | | | 0.16 | | | 0 | |
| | | | | | 200 | | 100 | |
| | | | | | 40 | | 43 | |
| | | | | | 8 | | 0 | |
| 0.5 | 10 | | | | | 1:20 | 100 | 100 |
| 0.5 | 2 | | | | | 1:4 | 100 | 95 |
| 0.5 | 0.4 | | | | | 1:0.8 | 80 | 25 |
| 0.5 | 0.080 | | | | | 1:0.16 | 23 | 19 |
| 0.5 | | 100 | | | | 1:200 | 98 | 99 |
| 0.5 | | 20 | | | | 1:40 | 100 | 100 |
| 0.5 | | 4 | | | | 1:8 | 100 | 100 |
| 0.5 | | 0.8 | | | | 1:1.6 | 97 | 12 |
| 0.020 | | 100 | | | | 1:5000 | 100 | 99 |
| 0.020 | | 20 | | | | 1:1000 | 100 | 100 |
| 0.020 | | 4 | | | | 1:200 | 100 | 100 |
| 0.020 | | 0.8 | | | | 1:40 | 11 | 5 |
| 0.1 | | | 100 | | | 1:1000 | 53 | 15 |
| 0.1 | | | 20 | | | 1:200 | 8 | 4 |
| 0.1 | | | 4 | | | 1:40 | 0 | 0 |
| 0.1 | | | 0.8 | | | 1:8 | 0 | 0 |
| 0.020 | | | 100 | | | 1:5000 | 22 | 15 |
| 0.020 | | | 20 | | | 1:1000 | 16 | 4 |
| 0.020 | | | 4 | | | 1:200 | 0 | 0 |
| 0.020 | | | 0.8 | | | 1:40 | 26 | 0 |
| 0.5 | | | | 4 | | 1:8 | 23 | 19 |
| 0.5 | | | | 0.8 | | 1:1.6 | 13 | 7 |
| 0.5 | | | | 0.16 | | 1:0.32 | 0 | 7 |
| 0.1 | | | | 4 | | 1:40 | 27 | 13 |
| 0.1 | | | | 0.8 | | 1:8 | 51 | 0 |
| 0.1 | | | | 0.16 | | 1:1.6 | 15 | 0 |
| 0.004 | | | | | 200 | 1:50000 | 100 | 100 |
| 0.004 | | | | | 40 | 1:10000 | 71 | 47 |
| 0.004 | | | | | 8 | 1:2000 | 2 | 6 |

TABLE D1
in vitro-Test with Colletotrichum lindemuthianum

| | | | | | | | Colby |
|---|---|---|---|---|---|---|---|
| | | (2.038) | (3.020) | (1.002) | | | ex- |
| | (2.005) | isoflu- | trifloxy- | difeno- | | Effi- | pected |
| (I-655) | fluopyram | cypram | strobin | conazole | | cacy | value |
| (ppm) | (ppm) | (ppm) | (ppm) | (ppm) | Ratio | % | % |
| 0.5 | | | | | | 100 | |
| 0.1 | | | | | | 98 | |
| 0.020 | | | | | | 20 | |
| 0.004 | | | | | | 0 | |
| | 20 | | | | | 19 | |
| | 4 | | | | | 7 | |
| | 0.8 | | | | | 0 | |
| | 0.16 | | | | | 0 | |
| | | 1.0 | | | | 5 | |
| | | 0.2 | | | | 20 | |
| | | 0.04 | | | | 11 | |
| | | 0.008 | | | | 15 | |
| | | | 1.0 | | | 79 | |
| | | | 0.2 | | | 78 | |
| | | | 0.04 | | | 56 | |
| | | | | 1.0 | | 13 | |
| | | | | 0.2 | | 0 | |
| | | | | 0.04 | | 13 | |
| | | | | 0.008 | | 2 | |
| 0.020 | 20 | | | | 1:1000 | 51 | 52 |
| 0.020 | 4 | | | | 1:200 | 47 | 45 |
| 0.020 | 0.8 | | | | 1:40 | 44 | 41 |
| 0.020 | 0.16 | | | | 1:8 | 61 | 40 |
| 0.1 | | 1.0 | | | 1:10 | 100 | 85 |
| 0.1 | | 0.2 | | | 1:2 | 100 | 88 |
| 0.1 | | 0.04 | | | 1:0.4 | 91 | 86 |
| 0.1 | | 0.008 | | | 1:0.08 | 97 | 87 |
| 0.1 | | | 1.0 | | 1:10 | 100 | 97 |
| 0.1 | | | 0.2 | | 1:2 | 96 | 97 |
| 0.1 | | | 0.04 | | 1:0.4 | 96 | 93 |
| 0.020 | | | 1.0 | | 1:50 | 88 | 87 |
| 0.020 | | | 0.2 | | 1:10 | 82 | 86 |
| 0.020 | | | 0.04 | | 1:2 | 74 | 72 |
| 0.004 | | | 1.0 | | 1:250 | 83 | 83 |
| 0.004 | | | 0.2 | | 1:50 | 82 | 82 |
| 0.004 | | | 0.04 | | 1:10 | 72 | 63 |
| 0.1 | | | | 1.0 | 1:10 | 99 | 87 |
| 0.1 | | | | 0.2 | 1:2 | 92 | 85 |
| 0.1 | | | | 0.04 | 1:0.4 | 84 | 87 |
| 0.1 | | | | 0.008 | 1:0.08 | 95 | 85 |

TABLE D2
in vitro-Test with Colletotrichum lindemuthianum

| | | | | | | | Colby |
|---|---|---|---|---|---|---|---|
| | (1.018) | (13.001) | | (15.012) | | | ex- |
| | prothio- | fludio- | (5.003) | fosetyl- | | Effi- | pected |
| (I-655) | conazole | xonil | captan | aluminium | | cacy | value |
| (ppm) | (ppm) | (ppm) | (ppm) | (ppm) | Ratio | % | % |
| 0.5 | | | | | | 100 | |
| 0.1 | | | | | | 98 | |
| 0.020 | | | | | | 20 | |
| 0.004 | | | | | | 0 | |
| | 1.0 | | | | | 100 | |
| | 0.2 | | | | | 73 | |
| | | 1.0 | | | | 81 | |
| | | 0.2 | | | | 60 | |
| | | 0.04 | | | | 8 | |
| | | | 20 | | | 100 | |
| | | | 4 | | | 52 | |
| | | | | 100 | | 53 | |
| | | | | 20 | | 0 | |
| | | | | 4 | | 7 | |
| | | | | 0.8 | | 0 | |
| 0.5 | 1.0 | | | | 1:2 | 100 | 100 |
| 0.5 | 0.2 | | | | 1:0.4 | 100 | 100 |
| 0.1 | 1.0 | | | | 1:10 | 100 | 100 |
| 0.1 | 0.2 | | | | 1:2 | 100 | 100 |
| 0.020 | 1.0 | | | | 1:50 | 100 | 100 |
| 0.020 | 0.2 | | | | 1:10 | 95 | 78 |
| 0.004 | 1.0 | | | | 1:250 | 99 | 100 |
| 0.004 | 0.2 | | | | 1:50 | 80 | 73 |
| 0.020 | | 1.0 | | | 1:50 | 88 | 84 |
| 0.020 | | 0.2 | | | 1:10 | 78 | 67 |
| 0.020 | | 0.04 | | | 1:2 | 38 | 23 |
| 0.004 | | 1.0 | | | 1:250 | 88 | 82 |
| 0.004 | | 0.2 | | | 1:50 | 68 | 63 |
| 0.004 | | 0.04 | | | 1:10 | 0 | 14 |
| 0.1 | | | 20 | | 1:200 | 100 | 100 |
| 0.1 | | | 4 | | 1:40 | 100 | 98 |
| 0.020 | | | 20 | | 1:1000 | 100 | 100 |
| 0.020 | | | 4 | | 1:200 | 100 | 63 |
| 0.004 | | | 20 | | 1:5000 | 100 | 100 |
| 0.004 | | | 4 | | 1:1000 | 82 | 52 |
| 0.020 | | | | 100 | 1:5000 | 61 | 61 |
| 0.020 | | | | 20 | 1:1000 | 35 | 17 |
| 0.020 | | | | 4 | 1:200 | 18 | 23 |
| 0.020 | | | | 0.8 | 1:40 | 47 | 17 |
| 0.004 | | | | 100 | 1:25000 | 64 | 53 |
| 0.004 | | | | 20 | 1:5000 | 8 | 0 |
| 0.004 | | | | 4 | 1:1000 | 2 | 7 |
| 0.004 | | | | 0.8 | 1:200 | 0 | 0 |

TABLE D3
in vitro-Test with Colletotrichum lindemuthianum

| | | (17.012) | | | | |
|---|---|---|---|---|---|---|
| | (15.016) | Paeni- | | | | |
| | metra- | bacillus | (18.001) | | Effi- | Colby |
| (I-655) | fenone | terrae | FLiPPER | | cacy | expected |
| (ppm) | (ppm) | (ppm) | (ppm) | Ratio | % | value % |
| 0.5 | | | | | 100 | |
| 0.1 | | | | | 98 | |
| 0.020 | | | | | 20 | |
| 0.004 | | | | | 0 | |
| | 20 | | | | 10 | |
| | 4 | | | | 15 | |
| | | 200 | | | 100 | |
| | | 40 | | | 26 | |
| | | | 200 | | 0 | |
| | | | 40 | | 3 | |
| 0.5 | 20 | | | 1:40 | 100 | 100 |
| 0.1 | 20 | | | 1:200 | 98 | 100 |
| 0.020 | 20 | | | 1:1000 | 44 | 25 |
| 0.004 | 20 | | | 1:5000 | 19 | 10 |
| 0.5 | | 200 | | 1:400 | 100 | 100 |
| 0.5 | | 40 | | 1:80 | 95 | 100 |
| 0.020 | | 200 | | 1:10000 | 100 | 100 |
| 0.020 | | 40 | | 1:2000 | 44 | 41 |
| 0.004 | | 200 | | 1:50000 | 100 | 100 |
| 0.004 | | 40 | | 1:10000 | 47 | 41 |
| 0.1 | | | 200 | 1:400 | 98 | 100 |
| 0.1 | | | 40 | 1:80 | 96 | 100 |
| 0.020 | | | 200 | 1:10000 | 33 | 20 |
| 0.020 | | | 40 | 1:2000 | 48 | 23 |

TABLE D4
in vitro-Test with Colletotrichum lindemuthianum

| | | | | | | | Colby |
|---|---|---|---|---|---|---|---|
| | | (3.020) | (1.018) | (1.021) | | | ex- |
| | (2.005) | trifloxy- | prothio- | tebu- | | Effi- | pected |
| (I-746) | fluopyram | strobin | conazole | conazole | | cacy | value |
| (ppm) | (ppm) | (ppm) | (ppm) | (ppm) | Ratio | % | % |
| 0.5 | | | | | | 100 | |
| 0.1 | | | | | | 100 | |
| 0.020 | | | | | | 14 | |
| 0.004 | | | | | | 0 | |
| | 20 | | | | | 23 | |
| | 4 | | | | | 7 | |
| | 0.8 | | | | | 14 | |
| | 0.16 | | | | | 18 | |
| | | 1.0 | | | | 82 | |
| | | 0.2 | | | | 88 | |
| | | 0.04 | | | | 69 | |
| | | 0.008 | | | | 27 | |
| | | | 1.0 | | | 100 | |
| | | | 0.2 | | | 59 | |
| | | | 0.04 | | | 10 | |
| | | | | 1.0 | | 28 | |
| | | | | 0.2 | | 0 | |
| | | | | 0.04 | | 0 | |
| | | | | 0.008 | | 0 | |
| 0.020 | 20 | | | | 1:1000 | 70 | 48 |
| 0.020 | 4 | | | | 1:200 | 47 | 38 |
| 0.020 | 0.8 | | | | 1:40 | 44 | 42 |
| 0.020 | 0.16 | | | | 1:8 | 55 | 44 |
| 0.020 | | 1.0 | | | 1:50 | 90 | 85 |
| 0.020 | | 0.2 | | | 1:10 | 84 | 90 |
| 0.020 | | 0.04 | | | 1:2 | 84 | 74 |
| 0.020 | | 0.008 | | | 1:0.4 | 63 | 40 |
| 0.1 | | | 1.0 | | 1:10 | 100 | 100 |
| 0.1 | | | 0.2 | | 1:2 | 100 | 100 |
| 0.1 | | | 0.04 | | 1:0.4 | 98 | 100 |
| 0.020 | | | 1.0 | | 1:50 | 100 | 100 |
| 0.020 | | | 0.2 | | 1:10 | 73 | 65 |
| 0.020 | | | 0.04 | | 1:2 | 16 | 23 |
| 0.004 | | | 1.0 | | 1:250 | 100 | 100 |
| 0.004 | | | 0.2 | | 1:50 | 74 | 59 |
| 0.004 | | | 0.04 | | 1:10 | 14 | 10 |
| 0.020 | | | | 1.0 | 1:50 | 63 | 38 |
| 0.020 | | | | 0.2 | 1:10 | 30 | 14 |
| 0.020 | | | | 0.04 | 1:2 | 42 | 14 |
| 0.020 | | | | 0.008 | 1:0.4 | 45 | 14 |
| 0.004 | | | | 1.0 | 1:250 | 29 | 28 |
| 0.004 | | | | 0.2 | 1:50 | 0 | 0 |
| 0.004 | | | | 0.04 | 1:10 | 5 | 0 |
| 0.004 | | | | 0.008 | 1:2 | 17 | 0 |

TABLE D5
in vitro-Test with Colletotrichum lindemuthianum

| | (13.001) | (5.013) | (15.012) | | | Colby |
|---|---|---|---|---|---|---|
| (I-746) | fludioxonil | mancozeb | fosetylalumi- | | Efficacy | expected |
| (ppm) | (ppm) | (ppm) | nium (ppm) | Ratio | % | value % |
| 0.5 | | | | | 100 | |
| 0.1 | | | | | 100 | |
| 0.020 | | | | | 14 | |
| 0.004 | | | | | 0 | |
| | 5.0 | | | | 44 | |
| | 1.0 | | | | 81 | |
| | 0.2 | | | | 68 | |
| | | 10 | | | 100 | |
| | | 2 | | | 0 | |
| | | 0.4 | | | 0 | |
| | | 0.080 | | | 4 | |
| | | | 100 | | 70 | |
| | | | 20 | | 22 | |
| | | | 4 | | 0 | |
| 0.020 | 5.0 | | | 1:250 | 83 | 54 |
| 0.020 | 1.0 | | | 1:50 | 82 | 84 |
| 0.020 | 0.2 | | | 1:10 | 76 | 73 |
| 0.004 | 5.0 | | | 1:125 | 79 | 45 |
| 0.004 | 1.0 | | | 1:2500 | 85 | 81 |
| 0.004 | 0.2 | | | 1:50 | 81 | 68 |
| 0.1 | | 10 | | 1:100 | 100 | 100 |
| 0.1 | | 2 | | 1:20 | 100 | 100 |
| 0.1 | | 0.4 | | 1:4 | 99 | 100 |
| 0.1 | | 0.080 | | 1:0.8 | 100 | 100 |
| 0.020 | | 10 | | 1:500 | 100 | 100 |
| 0.020 | | 2 | | 1:100 | 42 | 20 |
| 0.020 | | 0.4 | | 1:20 | 24 | 20 |
| 0.020 | | 0.080 | | 1:4 | 21 | 24 |
| 0.004 | | 10 | | 1:2500 | 100 | 100 |
| 0.004 | | 2 | | 1:500 | 0 | 0 |
| 0.004 | | 0.4 | | 1:100 | 0 | 0 |
| 0.004 | | 0.080 | | 1:20 | 13 | 4 |
| 0.5 | | | 100 | 1:200 | 98 | 100 |
| 0.5 | | | 20 | 1:40 | 99 | 100 |
| 0.5 | | | 4 | 1:8 | 100 | 100 |
| 0.020 | | | 100 | 1:5000 | 74 | 76 |
| 0.020 | | | 20 | 1:1000 | 49 | 37 |
| 0.020 | | | 4 | 1:200 | 38 | 20 |

TABLE D6
in vitro-Test with Colletotrichum lindemuthianum

| | | | (17.012) | | | | |
|---|---|---|---|---|---|---|---|
| | | (17.001) | Paeni- | | | | |
| | (6.002) | Bacillus | bacillus | (18.001) | | | Colby |
| (I-746) | isotianil | subtilis | terrae | FLiPPER | | | expected |
| (ppm) | (ppm) | (ppm) | (ppm) | (ppm) | Ratio | Efficacy % | value % |
| 0.5 | | | | | | 100 | |
| 0.1 | | | | | | 100 | |
| 0.020 | | | | | | 14 | |
| 0.004 | | | | | | 0 | |
| | 100 | | | | | 17 | |
| | 20 | | | | | 0 | |
| | 4 | | | | | 19 | |
| | 0.8 | | | | | 7 | |
| | | 200 | | | | 0 | |
| | | 40 | | | | 0 | |
| | | 8 | | | | 0 | |
| | | 1.6 | | | | 0 | |
| | | | 200 | | | 99 | |
| | | | 40 | | | 30 | |
| | | | 8 | | | 31 | |
| | | | 1.6 | | | 3 | |
| | | | | 200 | | 0 | |
| | | | | 40 | | 11 | |
| | | | | 8 | | 36 | |
| | | | | 1.6 | | 5 | |
| 0.1 | 100 | | | | 1:1000 | 100 | 100 |
| 0.1 | 20 | | | | 1:200 | 100 | 100 |
| 0.1 | 4 | | | | 1:40 | 100 | 100 |
| 0.1 | 0.8 | | | | 1:8 | 100 | 100 |
| 0.020 | 100 | | | | 1:5000 | 32 | 30 |
| 0.020 | 20 | | | | 1:1000 | 23 | 17 |
| 0.020 | 4 | | | | 1:200 | 29 | 32 |
| 0.020 | 0.8 | | | | 1:40 | 49 | 23 |
| 0.004 | 100 | | | | 1:25000 | 20 | 17 |
| 0.004 | 20 | | | | 1:5000 | 14 | 0 |
| 0.004 | 4 | | | | 1:1000 | 20 | 19 |
| 0.004 | 0.8 | | | | 1:200 | 19 | 7 |
| 0.1 | | 200 | | | 1:2000 | 98 | 100 |
| 0.1 | | 40 | | | 1:400 | 100 | 100 |
| 0.1 | | 8 | | | 1:80 | 100 | 100 |
| 0.1 | | 1.6 | | | 1:16 | 100 | 100 |
| 0.020 | | 200 | | | 1:10000 | 78 | 17 |
| 0.020 | | 40 | | | 1:2000 | 40 | 17 |
| 0.020 | | 8 | | | 1:400 | 31 | 17 |
| 0.020 | | 1.6 | | | 1:80 | 38 | 17 |
| 0.004 | | 200 | | | 1:50000 | 20 | 0 |
| 0.004 | | 40 | | | 1:10000 | 6 | 0 |
| 0.004 | | 8 | | | 1:2000 | 0 | 0 |
| 0.004 | | 1.6 | | | 1:400 | 18 | 0 |
| 0.5 | | | 200 | | 1:400 | 100 | 100 |
| 0.5 | | | 40 | | 1:80 | 99 | 100 |
| 0.5 | | | 8 | | 1:16 | 99 | 100 |
| 0.5 | | | 1.6 | | 1:3.2 | 100 | 100 |
| 0.020 | | | 200 | | 1:10000 | 100 | 99 |
| 0.020 | | | 40 | | 1:2000 | 44 | 42 |
| 0.020 | | | 8 | | 1:400 | 41 | 42 |
| 0.020 | | | 1.6 | | 1:80 | 47 | 19 |
| 0.5 | | | | 200 | 1:400 | 99 | 100 |
| 0.5 | | | | 40 | 1:80 | 100 | 100 |
| 0.5 | | | | 8 | 1:16 | 99 | 100 |
| 0.5 | | | | 1.6 | 1:3.2 | 98 | 100 |
| 0.020 | | | | 200 | 1:10000 | 26 | 17 |
| 0.020 | | | | 40 | 1:2000 | 31 | 26 |
| 0.020 | | | | 8 | 1:400 | 57 | 47 |
| 0.020 | | | | 1.6 | 1:80 | 50 | 20 |

TABLE D7
in vitro-Test with Colletotrichum lindemuthianum

| | (2.038) | | | | | |
|---|---|---|---|---|---|---|
| | isoflu- | (3.020) | (1.018) | | | Colby |
| (I-749) | cypram | trifloxystrobin | prothioconazole | | | expected |
| (ppm) | (ppm) | (ppm) | (ppm) | Ratio | Efficacy % | value % |
| 0.5 | | | | | 100 | |
| 0.1 | | | | | 100 | |
| 0.020 | | | | | 19 | |
| 0.004 | | | | | 1 | |
| | 0.2 | | | | 5 | |
| | 0.04 | | | | 0 | |
| | 0.008 | | | | 8 | |
| | | 1.0 | | | 80 | |
| | | 0.2 | | | 77 | |
| | | 0.04 | | | 49 | |
| | | 0.008 | | | 25 | |
| | | | 1.0 | | 100 | |
| | | | 0.2 | | 55 | |
| | | | 0.04 | | 0 | |
| | | | 0.008 | | 0 | |
| 0.5 | 0.2 | | | 1:0.4 | 100 | 100 |
| 0.5 | 0.04 | | | 1:0.08 | 100 | 100 |
| 0.5 | 0.008 | | | 1:0.016 | 100 | 100 |
| 0.020 | 0.2 | | | 1:10 | 38 | 23 |
| 0.020 | 0.04 | | | 1:2 | 26 | 19 |
| 0.020 | 0.008 | | | 1:0.4 | 30 | 25 |
| 0.5 | | 1.0 | | 1:2 | 99 | 100 |
| 0.5 | | 0.2 | | 1:0.4 | 100 | 100 |
| 0.5 | | 0.04 | | 1:0.08 | 100 | 100 |
| 0.5 | | 0.008 | | 1:0.016 | 99 | 100 |
| 0.020 | | 1.0 | | 1:50 | 90 | 84 |
| 0.020 | | 0.2 | | 1:10 | 88 | 82 |
| 0.020 | | 0.04 | | 1:2 | 75 | 58 |
| 0.020 | | 0.008 | | 1:0.4 | 46 | 40 |
| 0.004 | | 1.0 | | 1:250 | 86 | 81 |
| 0.004 | | 0.2 | | 1:50 | 87 | 78 |
| 0.004 | | 0.04 | | 1:10 | 71 | 49 |
| 0.004 | | 0.008 | | 1:2 | 41 | 26 |
| 0.5 | | | 1.0 | 1:2 | 100 | 100 |
| 0.5 | | | 0.2 | 1:0.4 | 100 | 100 |
| 0.5 | | | 0.04 | 1:0.08 | 100 | 100 |
| 0.5 | | | 0.008 | 1:0.016 | 99 | 100 |
| 0.004 | | | 1.0 | 1:250 | 99 | 100 |
| 0.004 | | | 0.2 | 1:50 | 66 | 56 |
| 0.004 | | | 0.04 | 1:10 | 12 | 2 |
| 0.004 | | | 0.008 | 1:2 | 0 | 2 |

TABLE D8
in vitro-Test with Colletotrichum lindemuthianum

| | (1.021) | (5.003) | (17.001) | | | Colby |
|---|---|---|---|---|---|---|
| (I-749) | tebuconazole | captan | Bacillus subtilis | | | expected |
| (ppm) | (ppm) | (ppm) | (ppm) | Ratio | Efficacy % | value % |
| 0.5 | | | | | 100 | |
| 0.1 | | | | | 100 | |
| 0.020 | | | | | 19 | |
| 0.004 | | | | | 1 | |
| | 1.0 | | | | 38 | |
| | 0.2 | | | | 2 | |
| | 0.04 | | | | 20 | |
| | 0.008 | | | | 7 | |
| | | 20 | | | 100 | |
| | | 4 | | | 20 | |
| | | 0.8 | | | 0 | |
| | | | 200 | | 0 | |
| | | | 40 | | 0 | |
| | | | 8 | | 0 | |
| | | | 1.6 | | 7 | |
| 0.5 | 1.0 | | | 1:2 | 100 | 100 |
| 0.5 | 0.2 | | | 1:0.4 | 100 | 100 |
| 0.5 | 0.04 | | | 1:0.08 | 100 | 100 |
| 0.5 | 0.008 | | | 1:0.016 | 99 | 100 |
| 0.020 | 1.0 | | | 1:50 | 49 | 48 |
| 0.020 | 0.2 | | | 1:10 | 23 | 18 |
| 0.020 | 0.04 | | | 1:2 | 55 | 33 |
| 0.020 | 0.008 | | | 1:0.4 | 34 | 22 |
| 0.1 | | 20 | | 1:200 | 100 | 100 |
| 0.1 | | 4 | | 1:40 | 100 | 100 |
| 0.1 | | 0.8 | | 1:8 | 100 | 100 |
| 0.020 | | 20 | | 1:1000 | 100 | 100 |
| 0.020 | | 4 | | 1:200 | 100 | 38 |
| 0.020 | | 0.8 | | 1:40 | 18 | 22 |
| 0.004 | | 20 | | 1:5000 | 100 | 100 |
| 0.004 | | 4 | | 1:1000 | 100 | 24 |
| 0.004 | | 0.8 | | 1:200 | 0 | 5 |
| 0.5 | | | 200 | 1:400 | 98 | 100 |
| 0.5 | | | 40 | 1:80 | 99 | 100 |
| 0.5 | | | 8 | 1:16 | 100 | 100 |
| 0.5 | | | 1.6 | 1:3.2 | 99 | 100 |
| 0.020 | | | 200 | 1:10000 | 46 | 0 |
| 0.020 | | | 40 | 1:2000 | 0 | 0 |
| 0.020 | | | 8 | 1:400 | 11 | 0 |
| 0.020 | | | 1.6 | 1:80 | 21 | 7 |

TABLE D9
in vitro -Test with Colletotrichum lindemuthianum

| | (17.012) | | | | |
|---|---|---|---|---|---|
| | Paenibacillus | (18.001) | | | Colby |
| (I-749) | terrae | FLiPPER | | Efficacy | expected |
| (ppm) | (ppm) | (ppm) | Ratio | % | value % |
| 0.5 | | | | 100 | |
| 0.1 | | | | 100 | |
| 0.020 | | | | 19 | |
| 0.004 | | | | 1 | |
| | 200 | | | 100 | |
| | 40 | | | 12 | |
| | 8 | | | 0 | |
| | | 200 | | 0 | |
| | | 40 | | 23 | |
| | | 8 | | 2 | |
| | | 1.6 | | 0 | |
| 0.5 | 200 | | 1:400 | 99 | 100 |
| 0.5 | 40 | | 1:80 | 98 | 100 |
| 0.5 | 8 | | 1:16 | 99 | 100 |
| 0.020 | 200 | | 1:10000 | 100 | 100 |
| 0.020 | 40 | | 1:2000 | 30 | 12 |
| 0.020 | 8 | | 1:400 | 3 | 0 |
| 0.004 | 200 | | 1:50000 | 100 | 100 |
| 0.004 | 40 | | 1:10000 | 21 | 12 |
| 0.004 | 8 | | 1:2000 | 3 | 0 |
| 0.020 | | 200 | 1:10000 | 30 | 0 |
| 0.020 | | 40 | 1:2000 | 55 | 23 |
| 0.020 | | 8 | 1:400 | 37 | 2 |
| 0.020 | | 1.6 | 1:80 | 21 | 0 |
| 0.004 | | 200 | 1:50000 | 1 | 0 |
| 0.004 | | 40 | 1:10000 | 28 | 23 |
| 0.004 | | 8 | 1:2000 | 24 | 2 |
| 0.004 | | 1.6 | 1:400 | 0 | 0 |

TABLE E1
in vitro-Test with Cordana musae

| | (2.038) | (3.020) | (1.002) | | | Colby |
|---|---|---|---|---|---|---|
| (I-655) | isoflucypram | trifloxystrobin | difenoconazole | | | expected |
| (ppm) | (ppm) | (ppm) | (ppm) | Ratio | Efficacy % | value % |
| 0.5 | | | | | 100 | |
| 0.1 | | | | | 100 | |
| 0.020 | | | | | 4 | |
| 0.004 | | | | | 2 | |
| | 1.0 | | | | 18 | |
| | 0.2 | | | | 0 | |
| | 0.04 | | | | 10 | |
| | 0.008 | | | | 0 | |
| | | 0.2 | | | 66 | |
| | | 0.04 | | | 28 | |
| | | 0.008 | | | 29 | |
| | | | 1.0 | | 42 | |
| | | | 0.2 | | 0 | |
| | | | 0.04 | | 0 | |
| | | | 0.008 | | 0 | |
| 0.1 | 1.0 | | | 1:10 | 100 | 100 |
| 0.1 | 0.2 | | | 1:2 | 100 | 100 |
| 0.1 | 0.04 | | | 1:0.4 | 100 | 100 |
| 0.1 | 0.008 | | | 1:0.08 | 100 | 100 |
| 0.020 | 1.0 | | | 1:50 | 54 | 21 |
| 0.020 | 0.2 | | | 1:10 | 51 | 4 |
| 0.020 | 0.04 | | | 1:2 | 51 | 13 |
| 0.020 | 0.008 | | | 1:0.4 | 37 | 4 |
| 0.5 | | 0.2 | | 1:0.4 | 99 | 100 |
| 0.5 | | 0.04 | | 1:0.08 | 99 | 100 |
| 0.5 | | 0.008 | | 1:0.016 | 100 | 100 |
| 0.020 | | 0.2 | | 1:10 | 78 | 68 |
| 0.020 | | 0.04 | | 1:2 | 59 | 31 |
| 0.020 | | 0.008 | | 1:0.4 | 41 | 32 |
| 0.004 | | 0.2 | | 1:50 | 70 | 67 |
| 0.004 | | 0.04 | | 1:10 | 46 | 29 |
| 0.004 | | 0.008 | | 1:2 | 24 | 30 |
| 0.5 | | | 1.0 | 1:2 | 100 | 100 |
| 0.5 | | | 0.2 | 1:0.4 | 99 | 100 |
| 0.5 | | | 0.04 | 1:0.08 | 99 | 100 |
| 0.5 | | | 0.008 | 1:0.016 | 99 | 100 |
| 0.020 | | | 1.0 | 1:50 | 55 | 44 |
| 0.020 | | | 0.2 | 1:10 | 5 | 4 |
| 0.020 | | | 0.04 | 1:2 | 10 | 4 |
| 0.020 | | | 0.008 | 1:0.4 | 17 | 4 |

TABLE E2
in vitro-Test with Cordana musae

| | (1.055) | (13.001) | (13.005) | | | | |
|---|---|---|---|---|---|---|---|
| | mefentriflu- | fludio- | quino- | (5.003) | | | Colby |
| (I-655) | conazole | xonil | xyfen | captan | | Efficacy | expected |
| (ppm) | (ppm) | (ppm) | (ppm) | (ppm) | Ratio | % | value % |
| 0.5 | | | | | | 100 | |
| 0.1 | | | | | | 100 | |
| 0.020 | | | | | | 4 | |
| 0.004 | | | | | | 2 | |
| | 1.0 | | | | | 100 | |
| | 0.2 | | | | | 93 | |
| | | 5.0 | | | | 44 | |
| | | 1.0 | | | | 20 | |
| | | 0.2 | | | | 0 | |
| | | | 10 | | | 15 | |
| | | | 2 | | | 1 | |
| | | | | 20 | | 100 | |
| | | | | 4 | | 2 | |
| | | | | 0.8 | | 0 | |
| 0.5 | 1.0 | | | | 1:2 | 100 | 100 |
| 0.5 | 0.2 | | | | 1:0.4 | 100 | 100 |
| 0.020 | 1.0 | | | | 1:50 | 100 | 100 |
| 0.020 | 0.2 | | | | 1:10 | 97 | 95 |
| 0.004 | 1.0 | | | | 1:250 | 100 | 100 |
| 0.004 | 0.2 | | | | 1:50 | 100 | 93 |
| 0.1 | | 5.0 | | | 1:10 | 100 | 100 |
| 0.1 | | 1.0 | | | 1:2 | 99 | 100 |
| 0.1 | | 0.2 | | | 1:0.4 | 99 | 100 |
| 0.020 | | 5.0 | | | 1:250 | 78 | 66 |
| 0.020 | | 1.0 | | | 1:50 | 75 | 51 |
| 0.020 | | 0.2 | | | 1:10 | 84 | 38 |
| 0.004 | | 5.0 | | | 1:1250 | 57 | 50 |
| 0.004 | | 1.0 | | | 1:250 | 51 | 29 |
| 0.004 | | 0.2 | | | 1:50 | 16 | 12 |
| 0.1 | | | 10 | | 1:100 | 100 | 100 |
| 0.1 | | | 2 | | 1:20 | 100 | 99 |
| 0.020 | | | 10 | | 1:500 | 75 | 53 |
| 0.020 | | | 2 | | 1:100 | 54 | 45 |
| 0.5 | | | | 4 | 1:8 | 99 | 100 |
| 0.1 | | | | 4 | 1:40 | 100 | 99 |
| 0.020 | | | | 4 | 1:200 | 100 | 46 |
| 0.004 | | | | 4 | 1:1000 | 43 | 19 |

TABLE E3
in vitro -Test with Cordana musae

| | | (15.012) | | | |
|---|---|---|---|---|---|
| | (5.018) | fosetylalu- | | | Colby |
| (I-655) | propineb | minium | | Efficacy | expected |
| (ppm) | (ppm) | (ppm) | Ratio | % | value % |
| 0.5 | | | | 100 | |
| 0.1 | | | | 100 | |
| 0.020 | | | | 4 | |
| 0.004 | | | | 2 | |
| | 100 | | | 100 | |
| | 20 | | | 25 | |
| | 4 | | | 15 | |
| | | 100 | | 6 | |
| | | 20 | | 0 | |
| 0.5 | 100 | | 1:200 | 100 | 100 |
| 0.5 | 20 | | 1:40 | 100 | 100 |
| 0.5 | 4 | | 1:8 | 100 | 100 |
| 0.1 | 100 | | 1:5000 | 100 | 100 |
| 0.1 | 20 | | 1:1000 | 73 | 53 |
| 0.1 | 4 | | 1:200 | 62 | 47 |
| 0.020 | 100 | | 1:25000 | 100 | 100 |
| 0.020 | 20 | | 1:5000 | 66 | 25 |
| 0.020 | 4 | | 1:1000 | 30 | 15 |
| 0.5 | | 100 | 1:200 | 100 | 100 |
| 0.5 | | 20 | 1:40 | 100 | 100 |
| 0.020 | | 100 | 1:5000 | 43 | 42 |
| 0.020 | | 20 | 1:1000 | 48 | 38 |
| 0.004 | | 100 | 1:25000 | 27 | 6 |
| 0.004 | | 20 | 1:5000 | 10 | 0 |

TABLE E4
in vitro-Test with Cordana musae

| | (7.005) | (2.005) | (2.038) | | | Colby |
|---|---|---|---|---|---|---|
| (I-746) | pyrimethanil | fluopyram | isoflucypram | | Efficacy | expected |
| (ppm) | (ppm) | (ppm) | (ppm) | Ratio | % | value % |
| 0.5 | | | | | 100 | |
| 0.1 | | | | | 79 | |
| 0.020 | | | | | 10 | |
| 0.004 | | | | | 0 | |
| | 20 | | | | 15 | |
| | 0.8 | | | | 9 | |
| | 0.16 | | | | 0 | |
| | | 20 | | | 20 | |
| | | 4 | | | 5 | |
| | | 0.8 | | | 0 | |
| | | 0.16 | | | 0 | |
| | | | 1.0 | | 8 | |
| | | | 0.2 | | 0 | |
| | | | 0.04 | | 12 | |
| | | | 0.008 | | 0 | |
| 0.1 | 20 | | | 1:200 | 99 | 100 |
| 0.1 | 0.8 | | | 1:8 | 100 | 100 |
| 0.1 | 0.16 | | | 1:1.6 | 99 | 100 |
| 0.020 | 20 | | | 1:1000 | 56 | 27 |
| 0.020 | 0.8 | | | 1:40 | 28 | 21 |
| 0.020 | 0.16 | | | 1:8 | 41 | 14 |
| 0.004 | 20 | | | 1:5000 | 21 | 15 |
| 0.004 | 0.8 | | | 1:200 | 13 | 9 |
| 0.004 | 0.16 | | | 1:40 | 11 | 0 |
| 0.020 | | 20 | | 1:1000 | 64 | 31 |
| 0.020 | | 4 | | 1:200 | 42 | 18 |
| 0.020 | | 0.8 | | 1:40 | 26 | 14 |
| 0.020 | | 0.16 | | 1:8 | 22 | 14 |
| 0.004 | | 20 | | 1:5000 | 25 | 20 |
| 0.004 | | 4 | | 1:1000 | 16 | 5 |
| 0.004 | | 0.8 | | 1:200 | 10 | 0 |
| 0.004 | | 0.16 | | 1:40 | 23 | 0 |
| 0.1 | | | 1.0 | 1:10 | 100 | 81 |
| 0.1 | | | 0.2 | 1:2 | 100 | 79 |
| 0.1 | | | 0.04 | 1:0.4 | 85 | 81 |
| 0.1 | | | 0.008 | 1:0.08 | 84 | 79 |
| 0.020 | | | 1.0 | 1:50 | 55 | 17 |
| 0.020 | | | 0.2 | 1:10 | 39 | 10 |
| 0.020 | | | 0.04 | 1:2 | 17 | 20 |
| 0.020 | | | 0.008 | 1:0.4 | 15 | 10 |
| 0.004 | | | 1.0 | 1:250 | 23 | 8 |
| 0.004 | | | 0.2 | 1:50 | 0 | 0 |
| 0.004 | | | 0.04 | 1:10 | 25 | 12 |
| 0.004 | | | 0.008 | 1:2 | 0 | 0 |

TABLE E5
in vitro-Test with Cordana musae

| | | (3.020) | (1.055) | | | |
|---|---|---|---|---|---|---|
| | (3.025) | trifloxy- | mefentriflu- | | | Colby |
| (I-746) | fenpicoxamid | strobin | conazole | | Efficacy | expected |
| (ppm) | (ppm) | (ppm) | (ppm) | Ratio | % | value % |
| 0.5 | | | | | 100 | |
| 0.1 | | | | | 79 | |
| 0.020 | | | | | 10 | |
| 0.004 | | | | | 0 | |
| | 5.0 | | | | 74 | |
| | 1.0 | | | | 50 | |
| | | 0.2 | | | 58 | |
| | | 0.04 | | | 49 | |
| | | 0.008 | | | 19 | |
| | | | 1.0 | | 100 | |
| | | | 0.2 | | 79 | |
| | | | 0.008 | | 0 | |
| 0.5 | 5.0 | | | 1:10 | 100 | 100 |
| 0.5 | 1.0 | | | 1:2 | 100 | 100 |
| 0.020 | 5.0 | | | 1:250 | 85 | 77 |
| 0.020 | 1.0 | | | 1:50 | 60 | 55 |
| 0.004 | 5.0 | | | 1:1250 | 82 | 74 |
| 0.004 | 1.0 | | | 1:250 | 52 | 50 |
| 0.5 | | 0.2 | | 1:0.4 | 100 | 100 |
| 0.5 | | 0.04 | | 1:0.08 | 100 | 100 |
| 0.5 | | 0.008 | | 1:0.016 | 100 | 100 |
| 0.020 | | 0.2 | | 1:10 | 62 | 62 |
| 0.020 | | 0.04 | | 1:2 | 60 | 54 |
| 0.020 | | 0.008 | | 1:0.4 | 41 | 27 |
| 0.004 | | 0.2 | | 1:50 | 69 | 58 |
| 0.004 | | 0.04 | | 1:10 | 63 | 49 |
| 0.004 | | 0.008 | | 1:2 | 38 | 19 |
| 0.5 | | | 1.0 | 1:2 | 100 | 100 |
| 0.5 | | | 0.2 | 1:0.4 | 100 | 100 |
| 0.5 | | | 0.008 | 1:0.016 | 100 | 100 |
| 0.020 | | | 1.0 | 1:50 | 100 | 100 |
| 0.020 | | | 0.2 | 1:10 | 95 | 79 |
| 0.020 | | | 0.008 | 1:0.4 | 5 | 0 |
| 0.004 | | | 1.0 | 1:250 | 100 | 100 |
| 0.004 | | | 0.2 | 1:50 | 83 | 80 |
| 0.004 | | | 0.008 | 1:2 | 12 | 4 |

TABLE E6
in vitro-Test with Cordana musae

| | (1.018) | (1.021) | (1.020) | | | Colby |
|---|---|---|---|---|---|---|
| (I-746) | prothioconazole | tebuconazole | spiroxamine | | Efficacy | expected |
| (ppm) | (ppm) | (ppm) | (ppm) | Ratio | % | value % |
| 0.5 | | | | | 100 | |
| 0.1 | | | | | 79 | |
| 0.020 | | | | | 10 | |
| 0.004 | | | | | 0 | |
| | 0.2 | | | | 100 | |
| | 0.04 | | | | 64 | |
| | 0.008 | | | | 0 | |
| | | 1.0 | | | 99 | |
| | | 0.04 | | | 5 | |
| | | 0.008 | | | 0 | |
| | | | 20 | | 4 | |
| | | | 4 | | 0 | |
| | | | 0.8 | | 6 | |
| | | | 0.16 | | 0 | |
| 0.5 | 0.2 | | | 1:0.4 | 100 | 100 |
| 0.5 | 0.04 | | | 1:0.08 | 100 | 100 |
| 0.5 | 0.008 | | | 1:0.016 | 100 | 100 |
| 0.004 | 0.2 | | | 1:50 | 100 | 100 |
| 0.004 | 0.04 | | | 1:10 | 77 | 65 |
| 0.004 | 0.008 | | | 1:2 | 0 | 4 |
| 0.5 | | 1.0 | | 1:2 | 100 | 100 |
| 0.5 | | 0.04 | | 1:0.08 | 100 | 100 |
| 0.5 | | 0.008 | | 1:0.016 | 100 | 100 |
| 0.020 | | 1.0 | | 1:50 | 100 | 99 |
| 0.020 | | 0.04 | | 1:2 | 7 | 5 |
| 0.020 | | 0.008 | | 1:0.4 | 9 | 0 |
| 0.004 | | 1.0 | | 1:250 | 99 | 99 |
| 0.004 | | 0.04 | | 1:10 | 20 | 9 |
| 0.004 | | 0.008 | | 1:2 | 6 | 4 |
| 0.1 | | | 20 | 1:200 | 100 | 87 |
| 0.1 | | | 4 | 1:40 | 94 | 87 |
| 0.1 | | | 0.8 | 1:8 | 83 | 88 |
| 0.1 | | | 0.16 | 1:1.6 | 93 | 87 |
| 0.004 | | | 20 | 1:5000 | 20 | 4 |
| 0.004 | | | 4 | 1:1000 | 38 | 0 |
| 0.004 | | | 0.8 | 1:200 | 0 | 6 |
| 0.004 | | | 0.16 | 1:40 | 6 | 0 |

TABLE E7
in vitro-Test with Cordana musae

| | | (13.001) | (13.004) | | | Colby |
|---|---|---|---|---|---|---|
| (I-746) | (15.064) | fludioxonil | proquinazid | | Efficacy | expected |
| (ppm) | (ppm) | (ppm) | (ppm) | Ratio | % | value % |
| 0.5 | | | | | 100 | |
| 0.1 | | | | | 79 | |
| 0.020 | | | | | 10 | |
| 0.004 | | | | | 0 | |
| | 10 | | | | 5 | |
| | 2 | | | | 14 | |
| | 0.4 | | | | 18 | |
| | 0.080 | | | | 0 | |
| | | 5.0 | | | 36 | |
| | | 1.0 | | | 13 | |
| | | 0.2 | | | 15 | |
| | | | 10 | | 23 | |
| | | | 2 | | 0 | |
| 0.5 | 10 | | | 1:20 | 100 | 100 |
| 0.5 | 2 | | | 1:4 | 100 | 100 |
| 0.5 | 0.4 | | | 1:0.8 | 100 | 100 |
| 0.5 | 0.080 | | | 1:0.16 | 100 | 100 |
| 0.1 | 10 | | | 1:100 | 100 | 88 |
| 0.1 | 2 | | | 1:20 | 98 | 89 |
| 0.1 | 0.4 | | | 1:4 | 82 | 89 |
| 0.1 | 0.080 | | | 1:0.8 | 87 | 87 |
| 0.1 | | 5.0 | | 1:50 | 98 | 92 |
| 0.1 | | 1.0 | | 1:10 | 99 | 89 |
| 0.1 | | 0.2 | | 1:2 | 89 | 89 |
| 0.020 | | 5.0 | | 1:250 | 62 | 67 |
| 0.020 | | 1.0 | | 1:50 | 68 | 55 |
| 0.020 | | 0.2 | | 1:10 | 61 | 56 |
| 0.004 | | 5.0 | | 1:1250 | 34 | 36 |
| 0.004 | | 1.0 | | 1:250 | 42 | 13 |
| 0.004 | | 0.2 | | 1:50 | 0 | 15 |
| 0.5 | | | 10 | 1:20 | 100 | 100 |
| 0.5 | | | 2 | 1:4 | 99 | 100 |
| 0.1 | | | 10 | 1:100 | 96 | 90 |
| 0.1 | | | 2 | 1:20 | 91 | 87 |
| 0.004 | | | 10 | 1:2500 | 29 | 23 |
| 0.004 | | | 2 | 1:500 | 19 | 0 |

TABLE E8
in vitro-Test with Cordana musae

| | (5.003) | (5.018) | (15.012) | | | Colby |
|---|---|---|---|---|---|---|
| (I-746) | captan | propineb | fosetylaluminium | | Efficacy | expected |
| (ppm) | (ppm) | (ppm) | (ppm) | Ratio | % | value % |
| 0.5 | | | | | 100 | |
| 0.1 | | | | | 79 | |
| 0.020 | | | | | 10 | |
| 0.004 | | | | | 0 | |
| | 20 | | | | 100 | |
| | 4 | | | | 100 | |
| | 0.16 | | | | 0 | |
| | | 100 | | | 99 | |
| | | 20 | | | 59 | |
| | | 4 | | | 30 | |
| | | 0.8 | | | 0 | |
| | | | 100 | | 38 | |
| | | | 20 | | 0 | |
| | | | 4 | | 12 | |
| | | | 0.8 | | 0 | |
| 0.002 | 20 | | | 1:1000 | 100 | 100 |
| 0.002 | 4 | | | 1:200 | 100 | 100 |
| 0.002 | 0.16 | | | 1:8 | 36 | 24 |
| 0.004 | 20 | | | 1:5000 | 100 | 100 |
| 0.004 | 4 | | | 1:1000 | 100 | 100 |
| 0.004 | 0.16 | | | 1:40 | 20 | 0 |
| 0.5 | | 100 | | 1:200 | 100 | 100 |
| 0.5 | | 20 | | 1:40 | 100 | 100 |
| 0.5 | | 4 | | 1:8 | 100 | 100 |
| 0.5 | | 0.8 | | 1:1.6 | 100 | 100 |
| 0.020 | | 100 | | 1:5000 | 100 | 99 |
| 0.020 | | 20 | | 1:1000 | 76 | 60 |
| 0.020 | | 4 | | 1:200 | 62 | 31 |
| 0.020 | | 0.8 | | 1:40 | 51 | 2 |
| 0.5 | | | 100 | 1:200 | 100 | 100 |
| 0.5 | | | 20 | 1:40 | 99 | 100 |
| 0.5 | | | 4 | 1:8 | 99 | 100 |
| 0.5 | | | 0.8 | 1:1.6 | 99 | 100 |
| 0.020 | | | 100 | 1:5000 | 36 | 40 |
| 0.020 | | | 20 | 1:1000 | 44 | 2 |
| 0.020 | | | 4 | 1:200 | 31 | 14 |
| 0.020 | | | 0.8 | 1:40 | 16 | 2 |

TABLE E9
in vitro-Test with Cordana musae

| | (6.002) | (17.012) Paeni- | (18.001) | | | Colby |
|---|---|---|---|---|---|---|
| (I-746) | isotianil | bacillus terrae | FLiPPER | | Efficacy | expected |
| (ppm) | (ppm) | (ppm) | (ppm) | Ratio | % | value % |
| 0.5 | | | | | 100 | |
| 0.1 | | | | | 79 | |
| 0.020 | | | | | 10 | |
| 0.004 | | | | | 0 | |
| | 100 | | | | 16 | |
| | 20 | | | | 3 | |
| | | 200 | | | 100 | |
| | | 40 | | | 7 | |
| | | 8 | | | 0 | |
| | | 1.6 | | | 0 | |
| | | | 200 | | 15 | |
| | | | 40 | | 24 | |
| | | | 8 | | 13 | |
| | | | 1.6 | | 0 | |
| 0.5 | 100 | | | 1:200 | 100 | 100 |
| 0.5 | 20 | | | 1:40 | 100 | 100 |
| 0.002 | 100 | | | 1:5000 | 52 | 32 |
| 0.002 | 20 | | | 1:1000 | 45 | 21 |
| 0,004 | 100 | | | 1:25000 | 19 | 18 |
| 0.004 | 20 | | | 1:5000 | 6 | 5 |
| 0.5 | | 200 | | 1:400 | 100 | 100 |
| 0.5 | | 40 | | 1:80 | 99 | 100 |
| 0.5 | | 8 | | 1:16 | 100 | 100 |
| 0.5 | | 1.6 | | 1:3.2 | 99 | 100 |
| 0.004 | | 200 | | 1:50000 | 100 | 100 |
| 0.004 | | 40 | | 1:10000 | 38 | 9 |
| 0.004 | | 8 | | 1:2000 | 9 | 2 |
| 0.004 | | 1.6 | | 1:400 | 49 | 2 |
| 0.5 | | | 200 | 1:400 | 97 | 100 |
| 0.5 | | | 40 | 1:80 | 100 | 100 |
| 0.5 | | | 8 | 1:16 | 100 | 100 |
| 0.5 | | | 1.6 | 1:3.2 | 98 | 100 |
| 0.020 | | | 200 | 1:10000 | 41 | 31 |
| 0.020 | | | 40 | 1:2000 | 37 | 38 |
| 0.020 | | | 8 | 1:400 | 46 | 29 |
| 0.020 | | | 1.6 | 1:80 | 42 | 19 |

TABLE E10
in vitro-Test with Cordana musae

| | (3.020) | (1.021) | (1.020) | | | Colby |
|---|---|---|---|---|---|---|
| (I-749) | trifloxystrobin | tebuconazole | spiroxamine | | Efficacy | expected |
| (ppm) | (ppm) | (ppm) | (ppm) | Ratio | % | value % |
| 0.5 | | | | | 100 | |
| 0.1 | | | | | 100 | |
| 0.020 | | | | | 64 | |
| 0.004 | | | | | 0 | |
| | 0.2 | | | | 64 | |
| | 0.04 | | | | 45 | |
| | 0.008 | | | | 29 | |
| | | 1.0 | | | 38 | |
| | | 0.2 | | | 2 | |
| | | 0.04 | | | 20 | |
| | | 0.008 | | | 7 | |
| | | | 20 | | 3 | |
| | | | 4 | | 0 | |
| | | | 0.8 | | 0 | |
| | | | 0.16 | | 0 | |
| 0.5 | 0.2 | | | 1:0.4 | 100 | 100 |
| 0.5 | 0.04 | | | 1:0.08 | 100 | 100 |
| 0.5 | 0.008 | | | 1:0.016 | 100 | 100 |
| 0.004 | 0.2 | | | 1:50 | 75 | 65 |
| 0.004 | 0.04 | | | 1:10 | 60 | 47 |
| 0.004 | 0.008 | | | 1:2 | 36 | 31 |
| 0.5 | | 1.0 | | 1:2 | 100 | 100 |
| 0.5 | | 0.2 | | 1:0.4 | 100 | 100 |
| 0.5 | | 0.04 | | 1:0.08 | 100 | 100 |
| 0.5 | | 0.008 | | 1:0.016 | 99 | 100 |
| 0.020 | | 1.0 | | 1:50 | 49 | 48 |
| 0.020 | | 0.2 | | 1:10 | 23 | 18 |
| 0.020 | | 0.04 | | 1:2 | 55 | 33 |
| 0.020 | | 0.008 | | 1:0.4 | 34 | 22 |
| 0.5 | | | 20 | 1:40 | 100 | 100 |
| 0.5 | | | 4 | 1:8 | 100 | 100 |
| 0.5 | | | 0.8 | 1:1.6 | 100 | 100 |
| 0.5 | | | 0.16 | 1:0.32 | 100 | 100 |
| 0.004 | | | 20 | 1:5000 | 47 | 3 |
| 0.004 | | | 4 | 1:1000 | 10 | 0 |
| 0.004 | | | 0.8 | 1:200 | 0 | 0 |
| 0.004 | | | 0.16 | 1:40 | 0 | 0 |

TABLE E11
in vitro-Test with Cordana musae

| | (13.004) | | | (15.016) | | | Colby |
|---|---|---|---|---|---|---|---|
| | pro- | (5.010) | (5.018) | metra- | | | expected |
| (I-749) | quinazid | dithianon | propineb | fenone | | Efficacy | value |
| (ppm) | (ppm) | (ppm) | (ppm) | (ppm) | Ratio | % | % |
| 0.5 | | | | | | 100 | |
| 0.1 | | | | | | 100 | |
| 0.020 | | | | | | 64 | |
| 0.004 | | | | | | 0 | |
| | 10 | | | | | 1 | |
| | 2 | | | | | 0 | |
| | 0.4 | | | | | 0 | |
| | 0.080 | | | | | 0 | |
| | | 20 | | | | 98 | |
| | | 4 | | | | 99 | |
| | | 0.8 | | | | 9 | |
| | | 0.16 | | | | 0 | |
| | | | 100 | | | 100 | |
| | | | 20 | | | 42 | |
| | | | 0.8 | | | 0 | |
| | | | | 20 | | 22 | |
| | | | | 0.8 | | 0 | |
| | | | | 0.16 | | 0 | |
| 0.5 | 10 | | | | 1:20 | 100 | 100 |
| 0.5 | 2 | | | | 1:4 | 100 | 100 |
| 0.5 | 0.4 | | | | 1:0.8 | 100 | 100 |
| 0.5 | 0.080 | | | | 1:0.16 | 100 | 100 |
| 0.004 | 10 | | | | 1:2500 | 34 | 10 |
| 0.004 | 2 | | | | 1:500 | 10 | 9 |
| 0.004 | 0.4 | | | | 1:100 | 7 | 9 |
| 0.004 | 0.080 | | | | 1:20 | 41 | 9 |
| 0.5 | | 20 | | | 1:40 | 100 | 100 |
| 0.5 | | 4 | | | 1:8 | 99 | 100 |
| 0.5 | | 0.8 | | | 1:1.6 | 99 | 100 |
| 0.5 | | 0.16 | | | 1:0.32 | 100 | 100 |
| 0.004 | | 20 | | | 1:5000 | 99 | 98 |
| 0.004 | | 4 | | | 1:1000 | 99 | 99 |
| 0.004 | | 0.8 | | | 1:200 | 29 | 17 |
| 0.004 | | 0.16 | | | 1:40 | 0 | 9 |
| 0.5 | | | 100 | | 1:200 | 100 | 100 |
| 0.5 | | | 20 | | 1:40 | 100 | 100 |
| 0.5 | | | 0.8 | | 1:1.6 | 100 | 100 |
| 0.004 | | | 100 | | 1:25000 | 100 | 100 |
| 0.004 | | | 20 | | 1:5000 | 79 | 42 |
| 0.004 | | | 0.8 | | 1:200 | 18 | 0 |
| 0.004 | | | | 20 | 1:5000 | 32 | 22 |
| 0.004 | | | | 0.8 | 1:200 | 6 | 0 |
| 0.004 | | | | 0.16 | 1:40 | 16 | 0 |

TABLE F1
in vitro-Test with Dianorthe citri

| | (2.028) | (2.038) | (3.025) | (1.021) | | | Colby |
|---|---|---|---|---|---|---|---|
| | inpyr- | isoflu- | fenpicox- | tebu- | | | expected |
| (I-655) | fluxam | cypram | amid | conazole | | Efficacy | value |
| (ppm) | (ppm) | (ppm) | (ppm) | (ppm) | Ratio | % | % |
| 0.5 | | | | | | 100 | |
| 0.1 | | | | | | 13 | |
| 0.020 | | | | | | 0 | |
| 0.004 | | | | | | 0 | |
| | 1.0 | | | | | 92 | |
| | 0.2 | | | | | 47 | |
| | 0.04 | | | | | 23 | |
| | 0.008 | | | | | 0 | |
| | | 1.0 | | | | 49 | |
| | | 0.04 | | | | 0 | |
| | | | 5.0 | | | 94 | |
| | | | 1.0 | | | 87 | |
| | | | 0.04 | | | 0 | |
| | | | | 1.0 | | 98 | |
| | | | | 0.2 | | 96 | |
| | | | | 0.04 | | 47 | |
| | | | | 0.008 | | 0 | |
| 0.1 | 1.0 | | | | 1:10 | 90 | 93 |
| 0.1 | 0.2 | | | | 1:2 | 72 | 50 |
| 0.1 | 0.04 | | | | 1:0.4 | 33 | 27 |
| 0.1 | 0.008 | | | | 1:0.08 | 3 | 6 |
| 0.5 | | 1.0 | | | 1:2 | 100 | 100 |
| 0.5 | | 0.04 | | | 1:0.08 | 99 | 100 |
| 0.1 | | 1.0 | | | 1:10 | 62 | 56 |
| 0.1 | | 0.04 | | | 1:0.4 | 28 | 13 |
| 0.020 | | 1.0 | | | 1:50 | 68 | 49 |
| 0.020 | | 0.04 | | | 1:2 | 8 | 0 |
| 0.004 | | 1.0 | | | 1:250 | 43 | 49 |
| 0.004 | | 0.04 | | | 1:10 | 32 | 0 |
| 0.1 | | | 5.0 | | 1:50 | 94 | 94 |
| 0.1 | | | 1.0 | | 1:10 | 91 | 89 |
| 0.1 | | | 0.04 | | 1:0.4 | 11 | 13 |
| 0.020 | | | 5.0 | | 1:250 | 95 | 94 |
| 0.020 | | | 1.0 | | 1:50 | 92 | 87 |
| 0.020 | | | 0.04 | | 1:2 | 0 | 0 |
| 0.004 | | | 5.0 | | 1:1250 | 97 | 94 |
| 0.004 | | | 1.0 | | 1:250 | 94 | 87 |
| 0.004 | | | 0.04 | | 1:10 | 0 | 0 |
| 0.1 | | | | 1.0 | 1:10 | 98 | 98 |
| 0.1 | | | | 0.2 | 1:2 | 97 | 96 |
| 0.1 | | | | 0.04 | 1:0.4 | 59 | 47 |
| 0.1 | | | | 0.008 | 1:0.08 | 15 | 0 |

TABLE F2
in vitro-Test with Dianorthe citri

| | (13.004) | (13.005) | (5.003) | (5.012) | | | Colby |
|---|---|---|---|---|---|---|---|
| (I-655) | proquinazid | quinoxyfen | captan | folpet | | Efficacy | expected |
| (ppm) | (ppm) | (ppm) | (ppm) | (ppm) | Ratio | % | value % |
| 0.5 | | | | | | 100 | |
| 0.1 | | | | | | 13 | |
| 0.020 | | | | | | 0 | |
| 0.004 | | | | | | 0 | |
| | 10 | | | | | 19 | |
| | 0.08 | | | | | 0 | |
| | | 10 | | | | 54 | |
| | | 2 | | | | 30 | |
| | | | 0.8 | | | 53 | |
| | | | 0.16 | | | 94 | |
| | | | | 10 | | 99 | |
| | | | | 2 | | 99 | |
| | | | | 0.4 | | 53 | |
| 0.5 | 10 | | | | 1:20 | 99 | 100 |
| 0.5 | 0.08 | | | | 1:0.16 | 99 | 100 |
| 0.1 | 10 | | | | 1:100 | 34 | 19 |
| 0.1 | 0.08 | | | | 1:0.8 | 48 | 0 |
| 0.004 | 10 | | | | 1:2500 | 23 | 22 |
| 0.004 | 0.08 | | | | 1:20 | 2 | 3 |
| 0.1 | | 10 | | | 1:100 | 62 | 54 |
| 0.1 | | 2 | | | 1:20 | 45 | 30 |
| 0.5 | | | 0.8 | | 1:1.6 | 99 | 100 |
| 0.5 | | | 0.16 | | 1:0.32 | 99 | 100 |
| 0.1 | | | 0.8 | | 1:8 | 100 | 53 |
| 0.1 | | | 0.16 | | 1:1.6 | 99 | 94 |
| 0.020 | | | 0.8 | | 1:40 | 87 | 53 |
| 0.020 | | | 0.16 | | 1:8 | 100 | 94 |
| 0.5 | | | | 10 | 1:20 | 100 | 100 |
| 0.5 | | | | 2 | 1:4 | 100 | 100 |
| 0.5 | | | | 0.4 | 1:0.8 | 99 | 100 |
| 0.1 | | | | 10 | 1:100 | 100 | 99 |
| 0.1 | | | | 2 | 1:20 | 100 | 99 |
| 0.1 | | | | 0.4 | 1:4 | 94 | 53 |
| 0.004 | | | | 10 | 1:500 | 99 | 99 |
| 0.004 | | | | 2 | 1:100 | 100 | 99 |
| 0.004 | | | | 0.4 | 1:20 | 58 | 53 |

TABLE F3
in vitro-Test with Dianorthe citri

| | (5.013) | (5.018) | (6.002) | | | Colby |
|---|---|---|---|---|---|---|
| (I-655) | mancozeb | propineb | isotianil | | Efficacy | expected |
| (ppm) | (ppm) | (ppm) | (ppm) | Ratio | % | value % |
| 0.5 | | | | | 100 | |
| 0.1 | | | | | 13 | |
| 0.020 | | | | | 0 | |
| 0.004 | | | | | 0 | |
| | 10 | | | | 100 | |
| | 2 | | | | 52 | |
| | 0.4 | | | | 0 | |
| | 0.080 | | | | 0 | |
| | | 100 | | | 100 | |
| | | 20 | | | 98 | |
| | | 4 | | | 30 | |
| | | 0.8 | | | 0 | |
| | | | 20 | | 5 | |
| | | | 4 | | 19 | |
| 0.5 | 10 | | | 1:20 | 100 | 100 |
| 0.5 | 2 | | | 1:4 | 100 | 100 |
| 0.5 | 0.4 | | | 1:0.8 | 100 | 100 |
| 0.5 | 0.080 | | | 1:0.16 | 98 | 100 |
| 0.1 | 10 | | | 1:100 | 100 | 100 |
| 0.1 | 2 | | | 1:20 | 64 | 52 |
| 0.1 | 0.4 | | | 1:4 | 0 | 0 |
| 0.1 | 0.080 | | | 1:0.8 | 12 | 0 |
| 0.5 | | 100 | | 1:200 | 98 | 100 |
| 0.5 | | 20 | | 1:40 | 100 | 100 |
| 0.5 | | 4 | | 1:8 | 98 | 100 |
| 0.5 | | 0.8 | | 1:1.6 | 97 | 100 |
| 0.1 | | 100 | | 1:1000 | 100 | 100 |
| 0.1 | | 20 | | 1:200 | 100 | 98 |
| 0.1 | | 4 | | 1:40 | 86 | 30 |
| 0.1 | | 0.8 | | 1:8 | 0 | 0 |
| 0.020 | | 100 | | 1:5000 | 100 | 100 |
| 0.020 | | 20 | | 1:1000 | 100 | 98 |
| 0.020 | | 4 | | 1:200 | 61 | 30 |
| 0.020 | | 0.8 | | 1:40 | 4 | 0 |
| 0.5 | | | 20 | 1:40 | 100 | 100 |
| 0.5 | | | 4 | 1:8 | 100 | 100 |
| 0.020 | | | 20 | 1:1000 | 22 | 5 |
| 0.020 | | | 4 | 1:200 | 32 | 19 |
| 0.004 | | | 20 | 1:5000 | 21 | 10 |
| 0.004 | | | 4 | 1:1000 | 45 | 23 |

TABLE F4
in vitro-Test with Diaporthe citri

| | (2.038) | (3.025) | (1.002) | (1.055) | | | Colby |
|---|---|---|---|---|---|---|---|
| | isoflu- | fenpicox- | difeno- | mefentriflu- | | | expected |
| (I-746) | cypram | amid | conazole | conazole | | Efficacy | value |
| (ppm) | (ppm) | (ppm) | (ppm) | (ppm) | Ratio | % | % |
| 0.5 | | | | | | 51 | |
| 0.1 | | | | | | 2 | |
| 0.020 | | | | | | 0 | |
| 0.004 | | | | | | 0 | |
| | 1.0 | | | | | 41 | |
| | 0.2 | | | | | 0 | |
| | 0.04 | | | | | 0 | |
| | 0.008 | | | | | 0 | |
| | | 5.0 | | | | 93 | |
| | | 1.0 | | | | 73 | |
| | | 0.2 | | | | 5 | |
| | | 0.04 | | | | 0 | |
| | | | 1.0 | | | 88 | |
| | | | 0.2 | | | 0 | |
| | | | | 1.0 | | 100 | |
| | | | | 0.2 | | 100 | |
| | | | | 0.04 | | 85 | |
| 0.5 | 1.0 | | | | 1:2 | 95 | 61 |
| 0.5 | 0.2 | | | | 1:0.4 | 100 | 33 |
| 0.5 | 0.04 | | | | 1:0.08 | 100 | 33 |
| 0.5 | 0.008 | | | | 1:0.016 | 100 | 33 |
| 0.5 | | 5.0 | | | 1:10 | 93 | 95 |
| 0.5 | | 1.0 | | | 1:2 | 100 | 82 |
| 0.5 | | 0.2 | | | 1:0.4 | 100 | 36 |
| 0.5 | | 0.04 | | | 1:0.08 | 100 | 33 |
| 0.1 | | 5.0 | | | 1:50 | 94 | 93 |
| 0.1 | | 1.0 | | | 1:10 | 91 | 73 |
| 0.1 | | 0.2 | | | 1:2 | 20 | 5 |
| 0.1 | | 0.04 | | | 1:0.4 | 0 | 0 |
| 0.020 | | 5.0 | | | 1:250 | 95 | 93 |
| 0.020 | | 1.0 | | | 1:50 | 83 | 73 |
| 0.020 | | 0.2 | | | 1:10 | 0 | 5 |
| 0.020 | | 0.04 | | | 1:2 | 0 | 0 |
| 0.5 | | | 1.0 | | 1:2 | 100 | 92 |
| 0.5 | | | 0.2 | | 1:0.4 | 69 | 33 |
| 0.1 | | | 1.0 | | 1:10 | 94 | 88 |
| 0.5 | | | 0.2 | | 1:2 | 0 | 0 |
| 0.020 | | | 1.0 | | 1:50 | 93 | 88 |
| 0.020 | | | 0.2 | | 1:10 | 16 | 0 |
| 0.004 | | | 1.0 | | 1:250 | 86 | 88 |
| 0.004 | | | 0.2 | | 1:50 | 27 | 0 |
| 0.5 | | | | 1.0 | 1:2 | 100 | 100 |
| 0.5 | | | | 0.2 | 1:0.4 | 100 | 100 |
| 0.5 | | | | 0.04 | 1:0.08 | 100 | 93 |

TABLE F5
in vitro-Test with Dianorthe citri

| | (1.021) | (1.020) | | | | Colby |
|---|---|---|---|---|---|---|
| (I-746) | tebuconazole | spiroxamine | (15.064) | | Efficacy | expected |
| (ppm) | (ppm) | (ppm) | (ppm) | Ratio | % | value % |
| 0.5 | | | | | 51 | |
| 0.1 | | | | | 2 | |
| 0.020 | | | | | 0 | |
| 0.004 | | | | | 0 | |
| | 1.0 | | | | 99 | |
| | 0.2 | | | | 94 | |
| | 0.04 | | | | 39 | |
| | 0.008 | | | | 21 | |
| | | 20 | | | 6 | |
| | | 4 | | | 0 | |
| | | 0.8 | | | 0 | |
| | | 0.16 | | | 0 | |
| | | | 2 | | 5 | |
| | | | 0.4 | | 2 | |
| | | | 0.080 | | 11 | |
| 0.5 | 1.0 | | | 1:2 | 100 | 99 |
| 0.5 | 0.2 | | | 1:0.4 | 98 | 97 |
| 0.5 | 0.04 | | | 1:0.08 | 75 | 72 |
| 0.5 | 0.008 | | | 1:0.016 | 80 | 64 |
| 0.5 | | 20 | | 1:40 | 82 | 54 |
| 0.5 | | 4 | | 1:8 | 100 | 51 |
| 0.5 | | 0.8 | | 1:1.6 | 100 | 51 |
| 0.5 | | 0.16 | | 1:0.32 | 99 | 51 |
| 0.1 | | 20 | | 1:200 | 25 | 6 |
| 0.1 | | 4 | | 1:40 | 0 | 0 |
| 0.1 | | 0.8 | | 1:8 | 0 | 0 |
| 0.1 | | 0.16 | | 1:1.6 | 0 | 0 |
| 0.020 | | 20 | | 1:1000 | 11 | 6 |
| 0.020 | | 4 | | 1:200 | 0 | 0 |
| 0.020 | | 0.8 | | 1:40 | 0 | 0 |
| 0.020 | | 0.16 | | 1:8 | 2 | 0 |
| 0.5 | | | 2 | 1:4 | 100 | 53 |
| 0.5 | | | 0.4 | 1:0.8 | 97 | 52 |
| 0.5 | | | 0.080 | 1:0.16 | 98 | 56 |
| 0.1 | | | 2 | 1:20 | 5 | 5 |
| 0.1 | | | 0.4 | 1:4 | 0 | 2 |
| 0.1 | | | 0.080 | 1:0.8 | 16 | 11 |
| 0.020 | | | 2 | 1:100 | 19 | 5 |
| 0.020 | | | 0.4 | 1:20 | 12 | 2 |
| 0.020 | | | 0.080 | 1:4 | 9 | 11 |

TABLE F6
in vitro-Test with Diaporthe citri

| | (13.001) | (13.004) | (13.005) | | | | Colby |
|---|---|---|---|---|---|---|---|
| | fludio- | pro- | quin- | (5.003) | | | expected |
| (I-746) | xonil | quinazid | oxyfen | captan | | Efficacy | value |
| (ppm) | (ppm) | (ppm) | (ppm) | (ppm) | Ratio | % | % |
| 0.5 | | | | | | 51 | |
| 0.1 | | | | | | 2 | |
| 0.020 | | | | | | 0 | |
| 0.004 | | | | | | 0 | |
| | 5.0 | | | | | 10 | |
| | 1.0 | | | | | 45 | |
| | 0.2 | | | | | 0 | |
| | 0.04 | | | | | 12 | |
| | | 10 | | | | 5 | |
| | | 2 | | | | 0 | |
| | | 0.4 | | | | 11 | |
| | | 0.08 | | | | 16 | |
| | | | 2 | | | 0 | |
| | | | 0.4 | | | 0 | |
| | | | | 20 | | 100 | |
| | | | | 4 | | 100 | |
| | | | | 0.16 | | 49 | |
| 0.5 | 5.0 | | | | 1:10 | 99 | 56 |
| 0.5 | 1.0 | | | | 1:2 | 99 | 73 |
| 0.5 | 0.2 | | | | 1:0.4 | 98 | 51 |
| 0.5 | 0.04 | | | | 1:0.08 | 96 | 57 |
| 0.5 | | 10 | | | 1:20 | 99 | 53 |
| 0.5 | | 2 | | | 1:4 | 97 | 51 |
| 0.5 | | 0.4 | | | 1:0.8 | 93 | 56 |
| 0.5 | | 0.08 | | | 1:0.16 | 97 | 58 |
| 0.5 | | | 2 | | 1:4 | 100 | 96 |
| 0.5 | | | 0.4 | | 1:0.8 | 100 | 96 |
| 0.1 | | | 2 | | 1:20 | 9 | 0 |
| 0.1 | | | 0.4 | | 1:4 | 11 | 0 |
| 0.004 | | | 2 | | 1:500 | 17 | 1 |
| 0.004 | | | 0.4 | | 1:100 | 0 | 1 |
| 0.5 | | | | 20 | 1:40 | 100 | 100 |
| 0.5 | | | | 4 | 1:8 | 100 | 100 |
| 0.5 | | | | 0.16 | 1:0.32 | 97 | 98 |
| 0.1 | | | | 20 | 1:200 | 100 | 100 |
| 0.1 | | | | 4 | 1:40 | 100 | 100 |
| 0.1 | | | | 0.16 | 1:1.6 | 99 | 49 |
| 0.004 | | | | 20 | 1:5000 | 100 | 100 |
| 0.004 | | | | 4 | 1:1000 | 100 | 100 |
| 0.004 | | | | 0.16 | 1:40 | 85 | 50 |

TABLE F7
in vitro-Test with Diaporthe citri

| | (5.010) | (5.012) | (5.013) | | | Colby |
|---|---|---|---|---|---|---|
| (I-746) | dithianon | folpet | mancozeb | | Efficacy | expected |
| (ppm) | (ppm) | (ppm) | (ppm) | Ratio | % | value % |
| 0.5 | | | | | 51 | |
| 0.1 | | | | | 2 | |
| 0.020 | | | | | 0 | |
| 0.004 | | | | | 0 | |
| | 20 | | | | 97 | |
| | 4 | | | | 98 | |
| | 0.8 | | | | 34 | |
| | 0.16 | | | | 0 | |
| | | 10 | | | 98 | |
| | | 2 | | | 98 | |
| | | 0.4 | | | 36 | |
| | | 0.08 | | | 0 | |
| | | | 10 | | 100 | |
| | | | 2 | | 53 | |
| | | | 0.4 | | 0 | |
| | | | 0.080 | | 3 | |
| 0.5 | 20 | | | 1:40 | 99 | 100 |
| 0.5 | 4 | | | 1:8 | 99 | 100 |
| 0.5 | 0.8 | | | 1:1.6 | 98 | 97 |
| 0.5 | 0.16 | | | 1:0.32 | 98 | 96 |
| 0.004 | 20 | | | 1:5000 | 95 | 97 |
| 0.004 | 4 | | | 1:1000 | 99 | 98 |
| 0.004 | 0.8 | | | 1:200 | 44 | 35 |
| 0.004 | 0.16 | | | 1:40 | 0 | 1 |
| 0.1 | | 10 | | 1:100 | 98 | 98 |
| 0.1 | | 2 | | 1:20 | 98 | 98 |
| 0.1 | | 0.4 | | 1:4 | 66 | 36 |
| 0.1 | | 0.08 | | 1:0.8 | 0 | 0 |
| 0.004 | | 10 | | 1:2500 | 98 | 98 |
| 0.004 | | 2 | | 1:500 | 99 | 98 |
| 0.004 | | 0.4 | | 1:100 | 35 | 37 |
| 0.004 | | 0.08 | | 1:20 | 31 | 1 |
| 0.5 | | | 10 | 1:20 | 99 | 100 |
| 0.5 | | | 2 | 1:4 | 100 | 77 |
| 0.5 | | | 0.4 | 1:0.8 | 100 | 51 |
| 0.5 | | | 0.080 | 1:0.16 | 98 | 52 |

TABLE F8
in vitro-Test with Diaporthe citri

| | (5.018) | (15.012) | (15.016) | | | Colby |
|---|---|---|---|---|---|---|
| (I-746) | propineb | fosetylalumi- | metrafenone | | Efficacy | expected |
| (ppm) | (ppm) | nium (ppm) | (ppm) | Ratio | % | value % |
| 0.5 | | | | | 51 | |
| 0.1 | | | | | 2 | |
| 0.020 | | | | | 0 | |
| 0.004 | | | | | 0 | |
| | 100 | | | | 100 | |
| | 20 | | | | 100 | |
| | 4 | | | | 14 | |
| | 0.8 | | | | 0 | |
| | | 100 | | | 0 | |
| | | 20 | | | 4 | |
| | | 4 | | | 31 | |
| | | 0.8 | | | 22 | |
| | | | 4 | | 0 | |
| | | | 0.8 | | 0 | |
| | | | 0.16 | | 0 | |
| 0.5 | 100 | | | 1:200 | 100 | 100 |
| 0.5 | 20 | | | 1:40 | 100 | 100 |
| 0.5 | 4 | | | 1:8 | 100 | 57 |
| 0.5 | 0.8 | | | 1:1.6 | 98 | 51 |
| 0.020 | 100 | | | 1:5000 | 99 | 100 |
| 0.020 | 20 | | | 1:1000 | 99 | 100 |
| 0.020 | 4 | | | 1:200 | 44 | 14 |
| 0.020 | 0.8 | | | 1:40 | 0 | 0 |
| 0.5 | | 100 | | 1:200 | 95 | 51 |
| 0.5 | | 20 | | 1:40 | 55 | 53 |
| 0.5 | | 4 | | 1:8 | 77 | 66 |
| 0.5 | | 0.8 | | 1:1.6 | 73 | 61 |
| 0.5 | | | 4 | 1:8 | 94 | 51 |
| 0.5 | | | 0.8 | 1:1.6 | 95 | 51 |
| 0.5 | | | 0.16 | 1:0.32 | 99 | 51 |

TABLE F9
in vitro-Test with Diaporthe citri

| | | (17.001) | (17.012) | | | | Colby |
|---|---|---|---|---|---|---|---|
| | (6.002) | Bacillus | Paeni- | (18.001) | | | expected |
| (I-746) | isotianil | subtilis | bacillus | FLiPPER | | Efficacy | value |
| (ppm) | (ppm) | (ppm) | terrae (ppm) | (ppm) | Ratio | % | % |
| 0.5 | | | | | | 51 | |
| 0.1 | | | | | | 2 | |
| 0.020 | | | | | | 0 | |
| 0.004 | | | | | | 0 | |
| | 100 | | | | | 5 | |
| | 20 | | | | | 14 | |
| | 4 | | | | | 23 | |
| | 0.8 | | | | | 12 | |
| | | 200 | | | | 0 | |
| | | 40 | | | | 0 | |
| | | 8 | | | | 0 | |
| | | 1.6 | | | | 0 | |
| | | | 200 | | | 99 | |
| | | | 40 | | | 0 | |
| | | | 8 | | | 0 | |
| | | | 1.6 | | | 3 | |
| | | | | 200 | | 0 | |
| | | | | 40 | | 0 | |
| | | | | 8 | | 0 | |
| | | | | 1.6 | | 22 | |
| 0.5 | 100 | | | | 1:200 | 81 | 29 |
| 0.5 | 20 | | | | 1:40 | 100 | 36 |
| 0.5 | 4 | | | | 1:8 | 100 | 43 |
| 0.5 | 0.8 | | | | 1:1.6 | 97 | 34 |
| 0.5 | | 200 | | | 1:400 | 95 | 25 |
| 0.5 | | 40 | | | 1:80 | 99 | 25 |
| 0.5 | | 8 | | | 1:16 | 99 | 25 |
| 0.5 | | 1.6 | | | 1:3.2 | 99 | 25 |
| 0.5 | | | 200 | | 1:400 | 99 | 99 |
| 0.5 | | | 40 | | 1:80 | 92 | 25 |
| 0.5 | | | 8 | | 1:16 | 88 | 25 |
| 0.5 | | | 1.6 | | 1:3.2 | 95 | 28 |
| 0.5 | | | | 200 | 1:400 | 66 | 25 |
| 0.5 | | | | 40 | 1:80 | 98 | 25 |
| 0.5 | | | | 8 | 1:16 | 88 | 25 |
| 0.5 | | | | 1.6 | 1:3.2 | 92 | 42 |

TABLE F10
in vitro-Test with Dianorthe citri

| | (7.005) | | (2.028) | (3.025) | | | Colby |
|---|---|---|---|---|---|---|---|
| | pyrime- | (2.005) | inpyr- | fenpi- | | | expected |
| (I-749) | thanil | fluopyram | fluxam | coxamid | | Efficacy | value |
| (ppm) | (ppm) | (ppm) | (ppm) | (ppm) | Ratio | % | % |
| 0.5 | | | | | | 100 | |
| 0.1 | | | | | | 0 | |
| 0.020 | | | | | | 0 | |
| 0.004 | | | | | | 0 | |
| | 20 | | | | | 100 | |
| | 4 | | | | | 94 | |
| | 0.16 | | | | | 0 | |
| | | 20 | | | | 26 | |
| | | 4 | | | | 0 | |
| | | 0.16 | | | | 1 | |
| | | | 1.0 | | | 94 | |
| | | | 0.2 | | | 32 | |
| | | | 0.008 | | | 7 | |
| | | | | 5.0 | | 90 | |
| | | | | 1.0 | | 75 | |
| | | | | 0.2 | | 0 | |
| 0.1 | 20 | | | | 1:200 | 100 | 100 |
| 0.1 | 4 | | | | 1:40 | 98 | 94 |
| 0.1 | 0.16 | | | | 1:1.6 | 0 | 0 |
| 0.020 | 20 | | | | 1:1000 | 100 | 100 |
| 0.020 | 4 | | | | 1:200 | 100 | 94 |
| 0.020 | 0.16 | | | | 1:8 | 0 | 8 |
| 0.5 | | 20 | | | 1:40 | 100 | 100 |
| 0.5 | | 4 | | | 1:8 | 98 | 100 |
| 0.5 | | 0.16 | | | 1:0.32 | 92 | 100 |
| 0.020 | | 20 | | | 1:1000 | 31 | 32 |
| 0.020 | | 4 | | | 1:200 | 14 | 8 |
| 0.020 | | 0.16 | | | 1:8 | 9 | 8 |
| 0.5 | | | 1.0 | | 1:2 | 97 | 100 |
| 0.5 | | | 0.2 | | 1:0.4 | 97 | 100 |
| 0.5 | | | 0.008 | | 1:0.016 | 98 | 100 |
| 0.1 | | | 1.0 | | 1:10 | 96 | 94 |
| 0.1 | | | 0.2 | | 1:2 | 65 | 32 |
| 0.1 | | | 0.008 | | 1:0.08 | 0 | 7 |
| 0.1 | | | | 5.0 | 1:50 | 91 | 90 |
| 0.1 | | | | 1.0 | 1:10 | 77 | 75 |
| 0.1 | | | | 0.2 | 1:2 | 30 | 0 |
| 0.020 | | | | 5.0 | 1:250 | 95 | 90 |
| 0.020 | | | | 1.0 | 1:50 | 81 | 75 |
| 0.020 | | | | 0.2 | 1:10 | 0 | 0 |

TABLE F11
in vitro-Test with Diaporthe citri

| | (3.020) | (1.002) | | (5.010) | | | Colby |
|---|---|---|---|---|---|---|---|
| | trifloxy- | difeno- | (5.003) | dithia- | | | expected |
| (I-749) | strobin | conazole | captan | non | | Efficacy | value |
| (ppm) | (ppm) | (ppm) | (ppm) | (ppm) | Ratio | % | % |
| 0.5 | | | | | | 100 | |
| 0.1 | | | | | | 0 | |
| 0.020 | | | | | | 0 | |
| 0.004 | | | | | | 0 | |
| | 1.0 | | | | | 98 | |
| | 0.2 | | | | | 97 | |
| | 0.04 | | | | | 94 | |
| | 0.008 | | | | | 82 | |
| | | 1.0 | | | | 90 | |
| | | 0.2 | | | | 16 | |
| | | 0.04 | | | | 13 | |
| | | 0.008 | | | | 0 | |
| | | | 4 | | | 100 | |
| | | | 0.8 | | | 15 | |
| | | | 0.16 | | | 41 | |
| | | | | 20 | | 98 | |
| | | | | 4 | | 98 | |
| | | | | 0.8 | | 35 | |
| 0.1 | 1.0 | | | | 1:10 | 99 | 98 |
| 0.1 | 0.2 | | | | 1:2 | 96 | 97 |
| 0.1 | 0.04 | | | | 1:0.4 | 94 | 94 |
| 0.1 | 0.008 | | | | 1:0.08 | 91 | 82 |
| 0.020 | | 1.0 | | | 1:50 | 90 | 90 |
| 0.020 | | 0.2 | | | 1:10 | 19 | 16 |
| 0.020 | | 0.04 | | | 1:2 | 11 | 13 |
| 0.020 | | 0.008 | | | 1:0.4 | 0 | 0 |
| 0.1 | | | 4 | | 1:40 | 100 | 100 |
| 0.1 | | | 0.8 | | 1:8 | 53 | 19 |
| 0.1 | | | 0.16 | | 1:1.6 | 100 | 44 |
| 0.020 | | | 4 | | 1:200 | 100 | 100 |
| 0.020 | | | 0.8 | | 1:40 | 32 | 15 |
| 0.020 | | | 0.16 | | 1:8 | 90 | 41 |
| 0.5 | | | | 20 | 1:40 | 100 | 100 |
| 0.5 | | | | 4 | 1:8 | 99 | 100 |
| 0.5 | | | | 0.8 | 1:1.6 | 97 | 100 |
| 0.004 | | | | 20 | 1:5000 | 95 | 98 |
| 0.004 | | | | 4 | 1:1000 | 99 | 99 |
| 0.004 | | | | 0.8 | 1:200 | 83 | 52 |

TABLE F12
in vitro-Test with Diaporthe citri

| | (5.012) | (5.013) | (5.018) | (6.002) | | | Colby |
|---|---|---|---|---|---|---|---|
| (I-749) | folpet | mancozeb | propineb | isotianil | | | expected |
| (ppm) | (ppm) | (ppm) | (ppm) | (ppm) | Ratio | Efficacy % | value % |
| 0.5 | | | | | | 100 | |
| 0.1 | | | | | | 0 | |
| 0.020 | | | | | | 0 | |
| 0.004 | | | | | | 0 | |
| | 2 | | | | | 98 | |
| | 0.4 | | | | | 33 | |
| | 0.08 | | | | | 20 | |
| | | 10 | | | | 100 | |
| | | 2 | | | | 45 | |
| | | 0.4 | | | | 1 | |
| | | | 100 | | | 97 | |
| | | | 20 | | | 100 | |
| | | | 4 | | | 23 | |
| | | | | 100 | | 0 | |
| | | | | 20 | | 0 | |
| | | | | 4 | | 24 | |
| | | | | 0.8 | | 0 | |
| 0.5 | 2 | | | | 1:4 | 99 | 100 |
| 0.5 | 0.4 | | | | 1:0.8 | 98 | 100 |
| 0.5 | 0.08 | | | | 1:0.16 | 99 | 100 |
| 0.1 | 2 | | | | 1:20 | 99 | 98 |
| 0.1 | 0.4 | | | | 1:4 | 74 | 36 |
| 0.1 | 0.08 | | | | 1:0.8 | 15 | 23 |
| 0.020 | 2 | | | | 1:100 | 99 | 98 |
| 0.020 | 0.4 | | | | 1:20 | 42 | 33 |
| 0.020 | 0.08 | | | | 1:4 | 24 | 20 |
| 0.5 | | 10 | | | 1:20 | 100 | 100 |
| 0.5 | | 2 | | | 1:4 | 100 | 100 |
| 0.5 | | 0.4 | | | 1:0.8 | 99 | 100 |
| 0.1 | | 10 | | | 1:100 | 100 | 100 |
| 0.1 | | 2 | | | 1:20 | 60 | 45 |
| 0.1 | | 0.4 | | | 1:4 | 0 | 1 |
| 0.004 | | 10 | | | 1:2500 | 100 | 100 |
| 0.004 | | 2 | | | 1:500 | 46 | 45 |
| 0.004 | | 0.4 | | | 1:100 | 21 | 1 |
| 0.1 | | | 100 | | 1:1000 | 98 | 97 |
| 0.1 | | | 20 | | 1:200 | 100 | 100 |
| 0.1 | | | 4 | | 1:40 | 47 | 23 |
| 0.020 | | | 100 | | 1:5000 | 100 | 97 |
| 0.020 | | | 20 | | 1:1000 | 100 | 100 |
| 0.020 | | | 4 | | 1:200 | 64 | 38 |
| 0.004 | | | 100 | | 1:25000 | 98 | 97 |
| 0.004 | | | 20 | | 1:5000 | 100 | 100 |
| 0.004 | | | 4 | | 1:1000 | 43 | 23 |
| 0.004 | | | | 100 | 1:25000 | 21 | 16 |
| 0.004 | | | | 20 | 1:5000 | 30 | 16 |
| 0.004 | | | | 4 | 1:1000 | 39 | 36 |
| 0.004 | | | | 0.8 | 1:200 | 27 | 16 |

TABLE G1
in vitro-Test with Fusarium culmorum

| | (3.020) | (1.055) | (1.021) | | | Colby |
|---|---|---|---|---|---|---|
| (I-655) | trifloxystrobin | mefentriflu- | tebuconazole | | Efficacy | expected |
| (ppm) | (ppm) | conazole (ppm) | (ppm) | Ratio | % | value % |
| 0.5 | | | | | 19 | |
| 0.1 | | | | | 7 | |
| 0.020 | | | | | 7 | |
| 0.004 | | | | | 0 | |
| | 1.0 | | | | 5 | |
| | 0.2 | | | | 7 | |
| | 0.04 | | | | 0 | |
| | 0.008 | | | | 0 | |
| | | 1.0 | | | 23 | |
| | | 0.2 | | | 0 | |
| | | | 1.0 | | 99 | |
| | | | 0.2 | | 65 | |
| 0.5 | 1.0 | | | 1:2 | 61 | 5 |
| 0.5 | 0.2 | | | 1:0.4 | 23 | 7 |
| 0.5 | 0.04 | | | 1:0.08 | 0 | 0 |
| 0.5 | 0.008 | | | 1:0.016 | 0 | 0 |
| 0.020 | 1.0 | | | 1:50 | 19 | 5 |
| 0.020 | 0.2 | | | 1:10 | 10 | 7 |
| 0.020 | 0.04 | | | 1:2 | 0 | 0 |
| 0.020 | 0.008 | | | 1:0.4 | 0 | 0 |
| 0.5 | | 1.0 | | 1:2 | 66 | 38 |
| 0.5 | | 0.2 | | 1:0.4 | 10 | 19 |
| 0.1 | | 1.0 | | 1:10 | 20 | 28 |
| 0.1 | | 0.2 | | 1:2 | 0 | 7 |
| 0.020 | | 1.0 | | 1:50 | 82 | 29 |
| 0.020 | | 0.2 | | 1:10 | 0 | 7 |
| 0.004 | | 1.0 | | 1:250 | 100 | 23 |
| 0.004 | | 0.2 | | 1:50 | 0 | 0 |
| 0.5 | | | 1.0 | 1:2 | 100 | 99 |
| 0.5 | | | 0.2 | 1:0.4 | 92 | 72 |
| 0.1 | | | 1.0 | 1:10 | 99 | 99 |
| 0.1 | | | 0.2 | 1:2 | 94 | 67 |
| 0.020 | | | 1.0 | 1:50 | 99 | 99 |
| 0.020 | | | 0.2 | 1:10 | 84 | 67 |
| 0.004 | | | 1.0 | 1:250 | 99 | 99 |
| 0.004 | | | 0.2 | 1:50 | 89 | 65 |

TABLE G2
in vitro-Test with Fusarium culmorum

| | (13.001) | | (5.010) | | (5.018) | | | Colby |
|---|---|---|---|---|---|---|---|---|
| | fludio- | (5.003) | dithia- | (5.012) | pro- | | | expected |
| (I-655) | xonil | captan | non | folpet | pineb | | | value |
| (ppm) | (ppm) | (ppm) | (ppm) | (ppm) | (ppm) | Ratio | Efficacy % | % |
| 0.5 | | | | | | | 19 | |
| 0.1 | | | | | | | 7 | |
| 0.020 | | | | | | | 7 | |
| 0.004 | | | | | | | 0 | |
| | 5.0 | | | | | | 100 | |
| | 1.0 | | | | | | 91 | |
| | 0.2 | | | | | | 0 | |
| | 0.04 | | | | | | 0 | |
| | | 20 | | | | | 5 | |
| | | 4 | | | | | 14 | |
| | | 0.8 | | | | | 2 | |
| | | 0.16 | | | | | 0 | |
| | | | 20 | | | | 100 | |
| | | | 4 | | | | 39 | |
| | | | 0.8 | | | | 0 | |
| | | | 0.16 | | | | 0 | |
| | | | | 10 | | | 100 | |
| | | | | 2 | | | 62 | |
| | | | | 0.4 | | | 0 | |
| | | | | | 100.00 | | 91 | |
| | | | | | 20 | | 0 | |
| | | | | | 4 | | 2 | |
| 0.5 | 5.0 | | | | | 1:10 | 100 | 100 |
| 0.5 | 1.0 | | | | | 1:2 | 98 | 91 |
| 0.5 | 0.2 | | | | | 1:0.4 | 0 | 0 |
| 0.5 | 0.04 | | | | | 1:0.08 | 0 | 0 |
| 0.1 | 5.0 | | | | | 1:50 | 99 | 100 |
| 0.1 | 1.0 | | | | | 1:10 | 96 | 92 |
| 0.1 | 0.2 | | | | | 1:2 | 12 | 6 |
| 0.1 | 0.04 | | | | | 1:0.4 | 8 | 6 |
| 0.5 | | 20 | | | | 1:40 | 100 | 5 |
| 0.5 | | 4 | | | | 1:8 | 29 | 14 |
| 0.5 | | 0.8 | | | | 1:1.6 | 0 | 2 |
| 0.5 | | 0.16 | | | | 1:0.32 | 0 | 0 |
| 0.5 | | | 20 | | | 1:40 | 100 | 100 |
| 0.5 | | | 4 | | | 1:8 | 100 | 39 |
| 0.5 | | | 0.8 | | | 1:1.6 | 0 | 0 |
| 0.5 | | | 0.16 | | | 1:0.32 | 0 | 0 |
| 0.1 | | | 20 | | | 1:200 | 100 | 100 |
| 0.1 | | | 4 | | | 1:40 | 99 | 39 |
| 0.1 | | | 0.8 | | | 1:8 | 0 | 0 |
| 0.1 | | | 0.16 | | | 1:1.6 | 0 | 0 |
| 0.5 | | | | 10 | | 1:20 | 100 | 100 |
| 0.5 | | | | 2 | | 1:4 | 100 | 62 |
| 0.5 | | | | 0.4 | | 1:0.8 | 0 | 0 |
| 0.1 | | | | 10 | | 1:100 | 100 | 100 |
| 0.1 | | | | 2 | | 1:20 | 100 | 62 |
| 0.1 | | | | 0.4 | | 1:4 | 0 | 0 |
| 0.020 | | | | 10 | | 1:500 | 100 | 100 |
| 0.020 | | | | 2 | | 1:100 | 90 | 62 |
| 0.020 | | | | 0.4 | | 1:20 | 0 | 0 |
| 0.004 | | | | 10 | | 1:2500 | 100 | 100 |
| 0.004 | | | | 2 | | 1:500 | 100 | 62 |
| 0.004 | | | | 0.4 | | 1:100 | 0 | 0 |
| 0.5 | | | | | 100.00 | 1:200 | 100 | 91 |
| 0.5 | | | | | 20 | 1:40 | 35 | 0 |
| 0.5 | | | | | 4 | 1:8 | 0 | 2 |

TABLE G3
in vitro-Test with Fusarium culmorum

| | | (2.038) | (3.025) | (3.020) | | | |
|---|---|---|---|---|---|---|---|
| | (2.005) | isoflu- | fenpi- | trifloxy- | | | Colby |
| (I-746) | fluopyram | cypram | coxamid | strobin | | | expected |
| (ppm) | (ppm) | (ppm) | (ppm) | (ppm) | Ratio | Efficacy % | value % |
| 0.5 | | | | | | 0 | |
| 0.1 | | | | | | 0 | |
| 0.020 | | | | | | 0 | |
| 0.004 | | | | | | 0 | |
| | 20 | | | | | 3 | |
| | 4 | | | | | 0 | |
| | 0.8 | | | | | 1 | |
| | 0.16 | | | | | 0 | |
| | | 1.0 | | | | 0 | |
| | | 0.2 | | | | 0 | |
| | | 0.04 | | | | 0 | |
| | | 0.008 | | | | 0 | |
| | | | 5.0 | | | 0 | |
| | | | 1.0 | | | 0 | |
| | | | 0.2 | | | 0 | |
| | | | 0.04 | | | 0 | |
| | | | | 1.0 | | 15 | |
| | | | | 0.2 | | 0 | |
| | | | | 0.04 | | 0 | |
| | | | | 0.008 | | 0 | |
| 0.5 | 20 | | | | 1:40 | 55 | 4 |
| 0.5 | 4 | | | | 1:8 | 0 | 1 |
| 0.5 | 0.8 | | | | 1:1.6 | 0 | 2 |
| 0.5 | 0.16 | | | | 1:0.32 | 0 | 1 |
| 0.5 | | 1.0 | | | 1:2 | 32 | 0 |
| 0.5 | | 0.2 | | | 1:0.4 | 0 | 0 |
| 0.5 | | 0.04 | | | 1:0.08 | 0 | 0 |
| 0.5 | | 0.008 | | | 1:0.016 | 0 | 0 |
| 0.5 | | | 5.0 | | 1:10 | 43 | 0 |
| 0.5 | | | 1.0 | | 1:2 | 0 | 0 |
| 0.5 | | | 0.2 | | 1:0.4 | 0 | 0 |
| 0.5 | | | 0.04 | | 1:0.08 | 0 | 0 |
| 0.5 | | | | 1.0 | 1:2 | 68 | 15 |
| 0.5 | | | | 0.2 | 1:0.4 | 0 | 0 |
| 0.5 | | | | 0.04 | 1:0.08 | 0 | 0 |
| 0.5 | | | | 0.008 | 1:0.016 | 0 | 0 |

TABLE G4
in vitro-Test with Fusarium culmorum

| | (1.002) | (1.021) | (1.020) | | | Colby |
|---|---|---|---|---|---|---|
| | difeno- | tebu- | spiro- | | | expected |
| (I-746) | conazole | conazole | xamine | | Efficacy | value |
| (ppm) | (ppm) | (ppm) | (ppm) | Ratio | % | % |
| 0.5 | | | | | 0 | |
| 0.1 | | | | | 0 | |
| 0.020 | | | | | 0 | |
| 0.004 | | | | | 0 | |
| | 1.0 | | | | 0 | |
| | 0.2 | | | | 0 | |
| | 0.04 | | | | 8 | |
| | 0.008 | | | | 3 | |
| | | 1.0 | | | 100 | |
| | | 0.2 | | | 25 | |
| | | 0.04 | | | 0 | |
| | | | 20 | | 2 | |
| | | | 4 | | 0 | |
| | | | 0.8 | | 0 | |
| | | | 0.16 | | 0 | |
| 0.5 | 1.0 | | | 1:2 | 62 | 0 |
| 0.5 | 0.2 | | | 1:0.4 | 0 | 0 |
| 0.5 | 0.04 | | | 1:0.08 | 0 | 8 |
| 0.5 | 0.008 | | | 1:0.016 | 0 | 3 |
| 0.5 | | 1.0 | | 1:2 | 100 | 100 |
| 0.5 | | 0.2 | | 1:0.4 | 100 | 25 |
| 0.5 | | 0.04 | | 1:0.08 | 0 | 0 |
| 0.1 | | 1.0 | | 1:10 | 100 | 100 |
| 0.1 | | 0.2 | | 1:2 | 94 | 25 |
| 0.1 | | 0.04 | | 1:0.4 | 0 | 0 |
| 0.020 | | 1.0 | | 1:50 | 99 | 100 |
| 0.020 | | 0.2 | | 1:10 | 32 | 27 |
| 0.020 | | 0.04 | | 1:2 | 0 | 2 |
| 0.5 | | | 20 | 1:40 | 9 | 3 |
| 0.5 | | | 4 | 1:8 | 0 | 2 |
| 0.5 | | | 0.8 | 1:1.6 | 0 | 2 |
| 0.5 | | | 0.16 | 1:0.32 | 0 | 2 |
| 0.1 | | | 20 | 1:200 | 15 | 2 |
| 0.1 | | | 4 | 1:40 | 5 | 0 |
| 0.1 | | | 0.8 | 1:8 | 10 | 0 |
| 0.1 | | | 0.16 | 1:1.6 | 8 | 0 |
| 0.004 | | | 20 | 1:5000 | 2 | 3 |
| 0.004 | | | 4 | 1:1000 | 9 | 1 |
| 0.004 | | | 0.8 | 1:200 | 12 | 1 |
| 0.004 | | | 0.16 | 1:40 | 2 | 1 |

TABLE G5
in vitro-Test with Fusarium culmorum

| | | (13.001) | (5.003) | | | Colby |
|---|---|---|---|---|---|---|
| (I-746) | (15.064) | fludioxonil | captan | | Efficacy | expected |
| (ppm) | (ppm) | (ppm) | (ppm) | Ratio | % | value % |
| 0.5 | | | | | 0 | |
| 0.1 | | | | | 0 | |
| 0.020 | | | | | 0 | |
| 0.004 | | | | | 0 | |
| | 10 | | | | 9 | |
| | 2 | | | | 1 | |
| | 0.4 | | | | 0 | |
| | | 10 | | | 11 | |
| | | 2 | | | 2 | |
| | | 0.4 | | | 1 | |
| | | 0.08 | | | 1 | |
| | | | 20 | | 100 | |
| | | | 4 | | 70 | |
| | | | 0.16 | | 0 | |
| 0.5 | 10 | | | 1:20 | 41 | 10 |
| 0.5 | 2 | | | 1:4 | 0 | 3 |
| 0.5 | 0.4 | | | 1:0.8 | 0 | 2 |
| 0.1 | 10 | | | 1:100 | 16 | 9 |
| 0.1 | 2 | | | 1:20 | 9 | 1 |
| 0.1 | 0.4 | | | 1:4 | 0 | 0 |
| 0.004 | 10 | | | 1:2500 | 13 | 10 |
| 0.004 | 2 | | | 1:500 | 0 | 2 |
| 0.004 | 0.4 | | | 1:100 | 0 | 1 |
| 0.5 | | 10 | | 1:20 | 55 | 12 |
| 0.5 | | 2 | | 1:4 | 0 | 4 |
| 0.5 | | 0.4 | | 1:0.8 | 0 | 3 |
| 0.5 | | 0.08 | | 1:0.16 | 0 | 2 |
| 0.004 | | 10 | | 1:2500 | 13 | 12 |
| 0.004 | | 2 | | 1:500 | 0 | 3 |
| 0.004 | | 0.4 | | 1:100 | 0 | 3 |
| 0.004 | | 0.08 | | 1:20 | 0 | 2 |
| 0.1 | | | 20 | 1:1000 | 100 | 100 |
| 0.1 | | | 4 | 1:200 | 72 | 70 |
| 0.1 | | | 0.16 | 1:8 | 0 | 0 |
| 0.1 | | | 20 | 1:5000 | 100 | 100 |
| 0.004 | | | 4 | 1:1000 | 99 | 70 |
| 0.004 | | | 0.16 | 1:40 | 0 | 0 |

TABLE G6
in vitro-Test with Fusarium culmorum

| | (5.010) | (5.012) | (5.018) | (15.016) | | | Colby |
|---|---|---|---|---|---|---|---|
| (I-746) | dithianon | folpet | propineb | metrafenone | | Efficacy | expected |
| (ppm) | (ppm) | (ppm) | (ppm) | (ppm) | Ratio | % | value % |
| 0.5 | | | | | | 0 | |
| 0.1 | | | | | | 0 | |
| 0.020 | | | | | | 0 | |
| 0.004 | | | | | | 0 | |
| | 20 | | | | | 99 | |
| | 4 | | | | | 44 | |
| | 0.8 | | | | | 0 | |
| | | 10 | | | | 100 | |
| | | 2 | | | | 63 | |
| | | 0.4 | | | | 0 | |
| | | | 100 | | | 94 | |
| | | | 20 | | | 0 | |
| | | | 4 | | | 0 | |
| | | | | 20 | | 0 | |
| | | | | 4 | | 0 | |
| | | | | 0.8 | | 0 | |
| 0.5 | 20 | | | | 1:40 | 100 | 99 |
| 0.5 | 4 | | | | 1:8 | 100 | 44 |
| 0.5 | 0.8 | | | | 1:1.6 | 0 | 0 |
| 0.1 | 20 | | | | 1:200 | 100 | 99 |
| 0.1 | 4 | | | | 1:40 | 100 | 44 |
| 0.1 | 0.8 | | | | 1:8 | 0 | 0 |
| 0.020 | 20 | | | | 1:1000 | 100 | 99 |
| 0.020 | 4 | | | | 1:200 | 72 | 44 |
| 0.020 | 0.8 | | | | 1:40 | 0 | 0 |
| 0.004 | 20 | | | | 1:5000 | 99 | 99 |
| 0.004 | 4 | | | | 1:1000 | 47 | 44 |
| 0.004 | 0.8 | | | | 1:200 | 0 | 0 |
| 0.5 | | 10 | | | 1:20 | 100 | 100 |
| 0.5 | | 2 | | | 1:4 | 100 | 63 |
| 0.5 | | 0.4 | | | 1:0.8 | 0 | 0 |
| 0.1 | | 10 | | | 1:100 | 100 | 100 |
| 0.1 | | 2 | | | 1:20 | 99 | 63 |
| 0.1 | | 0.4 | | | 1:4 | 0 | 0 |
| 0.020 | | 10 | | | 1:500 | 100 | 100 |
| 0.020 | | 2 | | | 1:100 | 99 | 63 |
| 0.020 | | 0.4 | | | 1:20 | 0 | 0 |
| 0.004 | | 10 | | | 1:2500 | 99 | 100 |
| 0.004 | | 2 | | | 1:500 | 100 | 63 |
| 0.004 | | 0.4 | | | 1:100 | 0 | 0 |
| 0.5 | | | 100 | | 1:200 | 100 | 94 |
| 0.5 | | | 20 | | 1:40 | 18 | 0 |
| 0.5 | | | 4 | | 1:8 | 0 | 0 |
| 0.5 | | | | 20 | 1:40 | 60 | 0 |
| 0.5 | | | | 4 | 1:8 | 0 | 0 |
| 0.5 | | | | 0.8 | 1:1.6 | 0 | 0 |

TABLE G7
in vitro-Test with Fusarium culmorum

| | (3.020) | (1.055) | (13.001) | (5.018) | | | |
|---|---|---|---|---|---|---|---|
| | trifloxy- | mefentriflu- | fludio- | pro- | | | Colby |
| (I-749) | strobin | conazole | xonil | pineb | | | expected |
| (ppm) | (ppm) | (ppm) | (ppm) | (ppm) | Ratio | Efficacy % | value % |
| 0.5 | | | | | | 18 | |
| 0.1 | | | | | | 11 | |
| 0.020 | | | | | | 10 | |
| 0.004 | | | | | | 0 | |
| | 1.0 | | | | | 11 | |
| | 0.2 | | | | | 2 | |
| | 0.04 | | | | | 0 | |
| | | 1.0 | | | | 6 | |
| | | 0.2 | | | | 3 | |
| | | | 5.0 | | | 100 | |
| | | | 1.0 | | | 94 | |
| | | | 0.2 | | | 0 | |
| | | | | 100 | | 78 | |
| | | | | 20 | | 17 | |
| | | | | 4 | | 0 | |
| 0.5 | 1.0 | | | | 1:2 | 72 | 21 |
| 0.5 | 0.2 | | | | 1:0.4 | 14 | 13 |
| 0.5 | 0.04 | | | | 1:0.08 | 4 | 11 |
| 0.1 | 1.0 | | | | 1:10 | 33 | 16 |
| 0.1 | 0.2 | | | | 1:2 | 15 | 7 |
| 0.1 | 0.04 | | | | 1:0.4 | 0 | 6 |
| 0.004 | 1.0 | | | | 1:250 | 14 | 11 |
| 0.004 | 0.2 | | | | 1:50 | 0 | 2 |
| 0.004 | 0.04 | | | | 1:10 | 0 | 0 |
| 0.5 | | 1.0 | | | 1:2 | 70 | 23 |
| 0.5 | | 0.2 | | | 1:0.4 | 10 | 20 |
| 0.1 | | 1.0 | | | 1:10 | 70 | 16 |
| 0.1 | | 0.2 | | | 1:2 | 14 | 13 |
| 0.020 | | 1.0 | | | 1:50 | 69 | 16 |
| 0.020 | | 0.2 | | | 1:10 | 9 | 13 |
| 0.5 | | | 5.0 | | 1:10 | 100 | 100 |
| 0.5 | | | 1.0 | | 1:2 | 98 | 94 |
| 0.5 | | | 0.2 | | 1:0.4 | 10 | 8 |
| 0.004 | | | 5.0 | | 1:1250 | 99 | 100 |
| 0.004 | | | 1.0 | | 1:250 | 100 | 94 |
| 0.004 | | | 0.2 | | 1:50 | 0 | 0 |
| 0.5 | | | | 100 | 1:200 | 100 | 81 |
| 0.5 | | | | 20 | 1:40 | 47 | 29 |
| 0.5 | | | | 4 | 1:8 | 10 | 14 |
| 0.1 | | | | 100 | 1:1000 | 80 | 78 |
| 0.1 | | | | 20 | 1:200 | 37 | 17 |
| 0.1 | | | | 4 | 1:40 | 0 | 0 |

TABLE H1
in vitro-Test with Parastagonospora nodorum

| | (7.005) | (2.002) | (3.020) | (1.055) | | | |
|---|---|---|---|---|---|---|---|
| | pyrime- | bixafen | trifloxy- | mefentriflu- | | | Colby |
| (I-655) | thanil | (ppm) | strobin | conazole | | | expected |
| (ppm) | (ppm) | | (ppm) | (ppm) | Ratio | Efficacy % | value % |
| 0.5 | | | | | | 100 | |
| 0.1 | | | | | | 41 | |
| 0.020 | | | | | | 0 | |
| 0.004 | | | | | | 0 | |
| | 4 | | | | | 100 | |
| | 0.8 | | | | | 100 | |
| | 0.16 | | | | | 4 | |
| | | 1.0 | | | | 41 | |
| | | 0.2 | | | | 34 | |
| | | | 1.0 | | | 79 | |
| | | | 0.2 | | | 78 | |
| | | | 0.04 | | | 63 | |
| | | | 0.008 | | | 38 | |
| | | | | 1.0 | | 100 | |
| | | | | 0.2 | | 99 | |
| | | | | 0.04 | | 97 | |
| | | | | 0.008 | | 85 | |
| 0.1 | 4 | | | | 1:40 | 100 | 100 |
| 0.1 | 0.8 | | | | 1:8 | 100 | 100 |
| 0.1 | 0.16 | | | | 1:1.6 | 100 | 43 |
| 0.020 | 4 | | | | 1:200 | 100 | 100 |
| 0.020 | 0.8 | | | | 1:40 | 100 | 100 |
| 0.020 | 0.16 | | | | 1:8 | 100 | 4 |
| 0.004 | 4 | | | | 1:1000 | 100 | 100 |
| 0.004 | 0.8 | | | | 1:200 | 100 | 100 |
| 0.004 | 0.16 | | | | 1:40 | 100 | 5 |
| 0.5 | | 1.0 | | | 1:2 | 100 | 100 |
| 0.5 | | 0.2 | | | 1:0.4 | 100 | 100 |
| 0.020 | | 1.0 | | | 1:50 | 47 | 41 |
| 0.020 | | 0.2 | | | 1:10 | 30 | 34 |
| 0.004 | | 1.0 | | | 1:250 | 57 | 41 |
| 0.004 | | 0.2 | | | 1:50 | 37 | 35 |
| 0.004 | | | 1.0 | | 1:250 | 85 | 79 |
| 0.004 | | | 0.2 | | 1:50 | 82 | 78 |
| 0.004 | | | 0.04 | | 1:10 | 56 | 63 |
| 0.004 | | | 0.008 | | 1:2 | 46 | 38 |
| 0.1 | | | | 1.0 | 1:10 | 100 | 100 |
| 0.1 | | | | 0.2 | 1:2 | 99 | 99 |
| 0.1 | | | | 0.04 | 1:0.4 | 100 | 98 |
| 0.1 | | | | 0.008 | 1:0.08 | 96 | 90 |

TABLE H2
in vitro-Test with Parastagonospora nodorum

| | | | | | (15.012) | | | |
|---|---|---|---|---|---|---|---|---|
| | (1.018) | (1.021) | | (5.013) | fosetyl- | | | |
| | prothio- | tebu- | (5.012) | man- | alumi- | | | Colby |
| (I-655) | conazole | conazole | folpet | cozeb | nium | | | expected |
| (ppm) | (ppm) | (ppm) | (ppm) | (ppm) | (ppm) | Ratio | Efficacy % | value % |
| 0.5 | | | | | | | 100 | |
| 0.1 | | | | | | | 41 | |
| 0.020 | | | | | | | 0 | |
| 0.004 | | | | | | | 0 | |
| | 1.0 | | | | | | 100 | |
| | 0.2 | | | | | | 99 | |
| | 0.04 | | | | | | 91 | |
| | 0.008 | | | | | | 28 | |
| | | 1.0 | | | | | 98 | |
| | | 0.2 | | | | | 79 | |
| | | 0.04 | | | | | 10 | |
| | | 0.008 | | | | | 0 | |
| | | | 10 | | | | 100 | |
| | | | 2 | | | | 91 | |
| | | | | 10 | | | 100 | |
| | | | | 2 | | | 17 | |
| | | | | 0.4 | | | 4 | |
| | | | | 0.080 | | | 0 | |
| | | | | | 100 | | 58 | |
| | | | | | 20 | | 28 | |
| 0.020 | 1.0 | | | | | 1:50 | 100 | 100 |
| 0.020 | 0.2 | | | | | 1:10 | 100 | 99 |
| 0.020 | 0.04 | | | | | 1:2 | 92 | 91 |
| 0.020 | 0.008 | | | | | 1:0.4 | 34 | 28 |
| 0.004 | 1.0 | | | | | 1:250 | 100 | 100 |
| 0.004 | 0.2 | | | | | 1:50 | 99 | 99 |
| 0.004 | 0.04 | | | | | 1:10 | 96 | 91 |
| 0.004 | 0.008 | | | | | 1:2 | 26 | 28 |
| 0.020 | | 1.0 | | | | 1:50 | 97 | 98 |
| 0.020 | | 0.2 | | | | 1:10 | 82 | 79 |
| 0.020 | | 0.04 | | | | 1:2 | 21 | 10 |
| 0.020 | | 0.008 | | | | 1:0.4 | 0 | 0 |
| 0.004 | | 1.0 | | | | 1:250 | 97 | 98 |
| 0.004 | | 0.2 | | | | 1:50 | 84 | 79 |
| 0.004 | | 0.04 | | | | 1:10 | 26 | 10 |
| 0.004 | | 0.008 | | | | 1:2 | 0 | 0 |
| 0.5 | | | 10 | | | 1:20 | 100 | 100 |
| 0.5 | | | 2 | | | 1:4 | 100 | 100 |
| 0.1 | | | 10 | | | 1:100 | 99 | 100 |
| 0.1 | | | 2 | | | 1:20 | 100 | 94 |
| 0.020 | | | 10 | | | 1:500 | 99 | 100 |
| 0.020 | | | 2 | | | 1:100 | 100 | 91 |
| 0.004 | | | 10 | | | 1:2500 | 100 | 100 |
| 0.004 | | | 2 | | | 1:500 | 100 | 92 |
| 0.5 | | | | 10 | | 1:20 | 100 | 100 |
| 0.5 | | | | 2 | | 1:4 | 99 | 100 |
| 0.5 | | | | 0.4 | | 1:0.8 | 100 | 100 |
| 0.5 | | | | 0.080 | | 1:0.16 | 99 | 100 |
| 0.1 | | | | 10 | | 1:100 | 100 | 100 |
| 0.1 | | | | 2 | | 1:20 | 51 | 49 |
| 0.1 | | | | 0.4 | | 1:4 | 45 | 41 |
| 0.1 | | | | 0.080 | | 1:0.8 | 43 | 39 |
| 0.004 | | | | 10 | | 1:2500 | 100 | 100 |
| 0.004 | | | | 2 | | 1:500 | 20 | 17 |
| 0.004 | | | | 0.4 | | 1:100 | 8 | 4 |
| 0.004 | | | | 0.080 | | 1:20 | 2 | 0 |
| 0.5 | | | | | 100 | 1:200 | 100 | 100 |
| 0.5 | | | | | 20 | 1:40 | 99 | 100 |
| 0.020 | | | | | 100 | 1:5000 | 59 | 58 |
| 0.020 | | | | | 20 | 1:1000 | 31 | 28 |
| 0.004 | | | | | 100 | 1:25000 | 59 | 58 |
| 0.004 | | | | | 20 | 1:5000 | 43 | 28 |

TABLE H3
in vitro -Test with Parastagonospora nodorum

| | | | (1.055) | | | Colby |
|---|---|---|---|---|---|---|
| | (7.005) | (2.002) | mefentriflu- | | Effi- | ex- |
| (I-746) | pyrimethanil | bixafen | conazole | | cacy | pected |
| (ppm) | (ppm) | (ppm) | (ppm) | Ratio | % | value % |
| 0.5 | | | | | 100 | |
| 0.1 | | | | | 31 | |
| 0.020 | | | | | 0 | |
| 0.004 | | | | | 0 | |
| | 20 | | | | 100 | |
| | 4 | | | | 100 | |
| | 0.8 | | | | 99 | |
| | 0.16 | | | | 13 | |
| | | 1.0 | | | 45 | |
| | | 0.2 | | | 38 | |
| | | | 0.2 | | 99 | |
| | | | 0.04 | | 98 | |
| | | | 0.008 | | 81 | |
| 0.1 | 20 | | | 1:200 | 100 | 100 |
| 0.1 | 4 | | | 1:40 | 100 | 100 |
| 0.1 | 0.8 | | | 1:8 | 100 | 100 |
| 0.1 | 0.16 | | | 1:1.6 | 84 | 52 |
| 0.020 | 20 | | | 1:1000 | 100 | 100 |
| 0.020 | 4 | | | 1:200 | 100 | 100 |
| 0.020 | 0.8 | | | 1:40 | 100 | 99 |
| 0.020 | 0.16 | | | 1:8 | 52 | 18 |
| 0.5 | | 1.0 | | 1:2 | 100 | 100 |
| 0.5 | | 0.2 | | 1:0.4 | 99 | 100 |
| 0.020 | | 1.0 | | 1:50 | 53 | 48 |
| 0.020 | | 0.2 | | 1:10 | 53 | 41 |
| 0.004 | | 1.0 | | 1:250 | 50 | 45 |
| 0.004 | | 0.2 | | 1:50 | 42 | 38 |
| 0.1 | | | 0.2 | 1:2 | 100 | 99 |
| 0.1 | | | 0.04 | 1:0.4 | 100 | 99 |
| 0.1 | | | 0.008 | 1:0.08 | 98 | 89 |
| 0.020 | | | 0.2 | 1:10 | 98 | 99 |
| 0.020 | | | 0.04 | 1:2 | 97 | 98 |
| 0.020 | | | 0.008 | 1:0.4 | 87 | 81 |
| 0.004 | | | 0.2 | 1:50 | 97 | 99 |
| 0.004 | | | 0.04 | 1:10 | 98 | 98 |
| 0.004 | | | 0.008 | 1:2 | 91 | 81 |

TABLE H4
in vitro-Test with Parastagonospora nodorum

| | (1.018) | | | | | |
|---|---|---|---|---|---|---|
| | prothio- | (1.020) | (13.001) | | Effi- | Colby |
| (I-746) | conazole | spiroxamine | fludioxonil | | cacy | expected |
| (ppm) | (ppm) | (ppm) | (ppm) | Ratio | % | value % |
| 0.5 | | | | | 100 | |
| 0.1 | | | | | 31 | |
| 0.020 | | | | | 0 | |
| 0.004 | | | | | 0 | |
| | 1.0 | | | | 100 | |
| | 0.2 | | | | 99 | |
| | 0.04 | | | | 83 | |
| | | 20 | | | 0 | |
| | | 4 | | | 0 | |
| | | 0.8 | | | 6 | |
| | | | 5.0 | | 75 | |
| | | | 0.2 | | 0 | |
| | | | 0.04 | | 0 | |
| 0.5 | 1.0 | | | 1:2 | 100 | 100 |
| 0.5 | 0.2 | | | 1:0.4 | 99 | 100 |
| 0.5 | 0.04 | | | 1:0.08 | 99 | 100 |
| 0.020 | 1.0 | | | 1:50 | 100 | 100 |
| 0.020 | 0.2 | | | 1:10 | 98 | 99 |
| 0.020 | 0.04 | | | 1:2 | 87 | 84 |
| 0.004 | 1.0 | | | 1:250 | 100 | 100 |
| 0.004 | 0.2 | | | 1:50 | 99 | 99 |
| 0.004 | 0.04 | | | 1:10 | 86 | 83 |
| 0.5 | | 20 | | 1:40 | 100 | 100 |
| 0.5 | | 4 | | 1:8 | 100 | 100 |
| 0.5 | | 0.8 | | 1:1.6 | 100 | 100 |
| 0.1 | | 20 | | 1:200 | 72 | 37 |
| 0.1 | | 4 | | 1:40 | 43 | 37 |
| 0.1 | | 0.8 | | 1:8 | 38 | 41 |
| 0.004 | | 20 | | 1:5000 | 8 | 0 |
| 0.004 | | 4 | | 1:1000 | 18 | 0 |
| 0.004 | | 0.8 | | 1:200 | 0 | 6 |
| 0.5 | | | 5.0 | 1:10 | 100 | 100 |
| 0.5 | | | 0.2 | 1:0.4 | 99 | 100 |
| 0.5 | | | 0.04 | 1:0.08 | 100 | 100 |
| 0.1 | | | 5.0 | 1:50 | 97 | 84 |
| 0.1 | | | 0.2 | 1:2 | 81 | 37 |
| 0.1 | | | 0.04 | 1:0.4 | 40 | 37 |
| 0.020 | | | 5.0 | 1:250 | 83 | 76 |
| 0.020 | | | 0.2 | 1:10 | 0 | 2 |
| 0.020 | | | 0.04 | 1:2 | 0 | 2 |

TABLE H5
in vitro-Test with Parastagonospora nodorum

| | | | | (15.012) | | | Colby |
|---|---|---|---|---|---|---|---|
| | | (5.013) | (5.018) | fosetyl- | | | expec- |
| | (5.003) | man- | pro- | alu- | | Effi- | ted |
| (I-746) | captan | cozeb | pineb | minium | | cacy | value |
| (ppm) | (ppm) | (ppm) | (ppm) | (ppm) | Ratio | % | % |
| 0.5 | | | | | | 100 | |
| 0.1 | | | | | | 31 | |
| 0.020 | | | | | | 0 | |
| 0.004 | | | | | | 0 | |
| | 20 | | | | | 100 | |
| | 4 | | | | | 54 | |
| | 0.16 | | | | | 3 | |
| | | 10 | | | | 100 | |
| | | 2 | | | | 19 | |
| | | 0.4 | | | | 1 | |
| | | 0.080 | | | | 4 | |
| | | | 100 | | | 100 | |
| | | | 20 | | | 66 | |
| | | | 4 | | | 40 | |
| | | | 0.8 | | | 7 | |
| | | | | 100 | | 49 | |
| | | | | 20 | | 32 | |
| | | | | 4 | | 2 | |
| | | | | 0.8 | | 0 | |
| 0.5 | 20 | | | | 1:40 | 100 | 100 |
| 0.5 | 4 | | | | 1:8 | 100 | 100 |
| 0.5 | 0.16 | | | | 1:0.32 | 99 | 100 |
| 0.004 | 20 | | | | 1:5000 | 100 | 100 |
| 0.004 | 4 | | | | 1:1000 | 60 | 54 |
| 0.004 | 0.16 | | | | 1:40 | 2 | 3 |
| 0.1 | | 10 | | | 1:100 | 99 | 100 |
| 0.1 | | 2 | | | 1:20 | 42 | 44 |
| 0.1 | | 0.4 | | | 1:4 | 44 | 32 |
| 0.1 | | 0.080 | | | 1:0.8 | 38 | 34 |
| 0.020 | | | 100 | | 1:5000 | 100 | 100 |
| 0.020 | | | 20 | | 1:1000 | 70 | 66 |
| 0.020 | | | 4 | | 1:200 | 44 | 40 |
| 0.020 | | | 0.8 | | 1:40 | 13 | 7 |
| 0.020 | | | | 100 | 1:5000 | 58 | 49 |
| 0.020 | | | | 20 | 1:1000 | 32 | 32 |
| 0.020 | | | | 4 | 1:200 | 0 | 2 |
| 0.020 | | | | 0.8 | 1:40 | 0 | 0 |

TABLE H6
in vitro-Test with Parastagonospora nodorum

| | (7.005) | (2.002) | (2.005) | | Effi- | Colby |
|---|---|---|---|---|---|---|
| (I-749) | pyrimethanil | bixafen | fluopyram | | cacy | expected |
| (ppm) | (ppm) | (ppm) | (ppm) | Ratio | % | value % |
| 0.5 | | | | | 100 | |
| 0.1 | | | | | 92 | |
| 0.020 | | | | | 0 | |
| 0.004 | | | | | 0 | |
| | 4 | | | | 100 | |
| | 0.8 | | | | 99 | |
| | 0.16 | | | | 18 | |
| | | 1.0 | | | 33 | |
| | | 0.2 | | | 30 | |
| | | 0.04 | | | 3 | |
| | | | 20 | | 65 | |
| | | | 4 | | 41 | |
| | | | 0.8 | | 32 | |
| | | | 0.16 | | 0 | |
| 0.1 | 4 | | | 1:40 | 100 | 100 |
| 0.1 | 0.8 | | | 1:8 | 99 | 100 |
| 0.1 | 0.16 | | | 1:1.6 | 95 | 94 |
| 0.020 | 4 | | | 1:200 | 100 | 100 |
| 0.020 | 0.8 | | | 1:40 | 100 | 99 |
| 0.020 | 0.16 | | | 1:8 | 62 | 18 |
| 0.004 | 4 | | | 1:1000 | 100 | 100 |
| 0.004 | 0.8 | | | 1:200 | 100 | 99 |
| 0.004 | 0.16 | | | 1:40 | 23 | 18 |
| 0.5 | | 1.0 | | 1:2 | 100 | 100 |
| 0.5 | | 0.2 | | 1:0.4 | 100 | 100 |
| 0.5 | | 0.04 | | 1:0.08 | 100 | 100 |
| 0.020 | | 1.0 | | 1:50 | 39 | 33 |
| 0.020 | | 0.2 | | 1:10 | 35 | 30 |
| 0.020 | | 0.04 | | 1:2 | 0 | 3 |
| 0.004 | | 1.0 | | 1:250 | 39 | 33 |
| 0.004 | | 0.2 | | 1:50 | 33 | 30 |
| 0.004 | | 0.04 | | 1:10 | 2 | 3 |
| 0.020 | | | 20 | 1:1000 | 71 | 66 |
| 0.020 | | | 4 | 1:200 | 45 | 41 |
| 0.020 | | | 0.8 | 1:40 | 36 | 32 |
| 0.020 | | | 0.16 | 1:8 | 0 | 0 |
| 0.004 | | | 20 | 1:5000 | 69 | 65 |
| 0.004 | | | 4 | 1:1000 | 53 | 41 |
| 0.004 | | | 0.8 | 1:200 | 42 | 32 |
| 0.004 | | | 0.16 | 1:40 | 0 | 0 |

TABLE H7
in vitro-Test with Parastagonospora nodorum

| | (2.028) | (3.020) | (1.002) | (13.001) | | | |
|---|---|---|---|---|---|---|---|
| | inpyr- | trifloxy- | difeno- | fludio- | | Effi- | Colby |
| (I-749) | fluxam | strobin | conazole | xonil | | cacy | expected |
| (ppm) | (ppm) | (ppm) | (ppm) | (ppm) | Ratio | % | value % |
| 0.5 | | | | | | 100 | |
| 0.1 | | | | | | 92 | |
| 0.020 | | | | | | 0 | |
| 0.004 | | | | | | 0 | |
| | 1.0 | | | | | 33 | |
| | 0.2 | | | | | 33 | |
| | 0.04 | | | | | 23 | |
| | 0.008 | | | | | 0 | |
| | | 1.0 | | | | 83 | |
| | | 0.2 | | | | 75 | |
| | | 0.04 | | | | 61 | |
| | | 0.008 | | | | 36 | |
| | | | 1.0 | | | 97 | |
| | | | 0.2 | | | 83 | |
| | | | 0.04 | | | 16 | |
| | | | 0.008 | | | 0 | |
| | | | | 5.0 | | 75 | |
| | | | | 1.0 | | 34 | |
| | | | | 0.2 | | 0 | |
| | | | | 0.04 | | 0 | |
| 0.020 | 1.0 | | | | 1:50 | 41 | 33 |
| 0.020 | 0.2 | | | | 1:10 | 31 | 33 |
| 0.020 | 0.04 | | | | 1:2 | 14 | 23 |
| 0.020 | 0.008 | | | | 1:0.4 | 0 | 0 |
| 0.004 | 1.0 | | | | 1:250 | 44 | 33 |
| 0.004 | 0.2 | | | | 1:50 | 33 | 33 |
| 0.004 | 0.04 | | | | 1:10 | 28 | 23 |
| 0.004 | 0.008 | | | | 1:2 | 0 | 0 |
| 0.020 | | 1.0 | | | 1:50 | 82 | 83 |
| 0.020 | | 0.2 | | | 1:10 | 76 | 75 |
| 0.020 | | 0.04 | | | 1:2 | 62 | 61 |
| 0.020 | | 0.008 | | | 1:0.4 | 42 | 36 |
| 0.004 | | 1.0 | | | 1:250 | 81 | 83 |
| 0.004 | | 0.2 | | | 1:50 | 79 | 75 |
| 0.004 | | 0.04 | | | 1:10 | 58 | 61 |
| 0.004 | | 0.008 | | | 1:2 | 43 | 36 |
| 0.020 | | | 1.0 | | 1:50 | 98 | 97 |
| 0.020 | | | 0.2 | | 1:10 | 90 | 83 |
| 0.020 | | | 0.04 | | 1:2 | 21 | 16 |
| 0.020 | | | 0.008 | | 1:0.4 | 0 | 0 |
| 0.004 | | | 1.0 | | 1:250 | 98 | 97 |
| 0.004 | | | 0.2 | | 1:50 | 85 | 83 |
| 0.004 | | | 0.04 | | 1:10 | 16 | 16 |
| 0.004 | | | 0.008 | | 1:2 | 0 | 0 |
| 0.020 | | | | 5.0 | 1:250 | 84 | 75 |
| 0.020 | | | | 1.0 | 1:50 | 41 | 34 |
| 0.020 | | | | 0.2 | 1:10 | 0 | 0 |
| 0.020 | | | | 0.04 | 1:2 | 0 | 0 |
| 0.004 | | | | 5.0 | 1:1250 | 84 | 75 |
| 0.004 | | | | 1.0 | 1:250 | 52 | 34 |
| 0.004 | | | | 0.2 | 1:50 | 0 | 0 |
| 0.004 | | | | 0.04 | 1:10 | 0 | 0 |

TABLE I1
in vitro-Test with Ustilago segetum var. avenae

| | (2.038) | (3.020) | (1.002) | | | |
|---|---|---|---|---|---|---|
| | isoflu- | trifloxy- | difeno- | | Effi- | Colby |
| (I-655) | cypram | strobin | conazole | | cacy | expected |
| (ppm) | (ppm) | (ppm) | (ppm) | Ratio | % | value % |
| 0.5 | | | | | 0 | |
| 0.1 | | | | | 0 | |
| 0.020 | | | | | 6 | |
| 0.004 | | | | | 7 | |
| | 1.0 | | | | 100 | |
| | 0.2 | | | | 100 | |
| | 0.04 | | | | 22 | |
| | | 1.0 | | | 82 | |
| | | 0.2 | | | 53 | |
| | | | 1.0 | | 100 | |
| | | | 0.2 | | 57 | |
| | | | 0.04 | | 21 | |
| | | | 0.008 | | 14 | |
| 0.5 | 1.0 | | | 1:2 | 100 | 100 |
| 0.5 | 0.2 | | | 1:0.4 | 100 | 100 |
| 0.5 | 0.04 | | | 1:0.08 | 100 | 22 |
| 0.1 | 1.0 | | | 1:10 | 100 | 100 |
| 0.1 | 0.2 | | | 1:2 | 100 | 100 |
| 0.1 | 0.04 | | | 1:0.4 | 41 | 22 |
| 0.1 | | 1.0 | | 1:10 | 87 | 82 |
| 0.1 | | 0.2 | | 1:2 | 70 | 53 |
| 0.020 | | 1.0 | | 1:50 | 80 | 82 |
| 0.020 | | 0.2 | | 1:10 | 71 | 53 |
| 0.004 | | 1.0 | | 1:250 | 94 | 85 |
| 0.004 | | 0.2 | | 1:50 | 73 | 61 |
| 0.5 | | | 1.0 | 1:2 | 100 | 100 |
| 0.5 | | | 0.2 | 1:0.4 | 100 | 57 |
| 0.5 | | | 0.04 | 1:0.08 | 56 | 21 |
| 0.5 | | | 0.008 | 1:0.016 | 12 | 14 |
| 0.1 | | | 1.0 | 1:10 | 100 | 100 |
| 0.1 | | | 0.2 | 1:2 | 98 | 57 |
| 0.1 | | | 0.04 | 1:0.4 | 21 | 21 |
| 0.1 | | | 0.008 | 1:0.08 | 18 | 14 |
| 0.020 | | | 1.0 | 1:50 | 100 | 100 |
| 0.020 | | | 0.2 | 1:10 | 96 | 57 |
| 0.020 | | | 0.04 | 1:2 | 22 | 21 |
| 0.020 | | | 0.008 | 1:0.4 | 16 | 14 |

TABLE I2
in vitro-Test with Ustilago segetum var. avenae

| | (1.055) | | (5.010) | (5.013) | (5.018) | | | Colby |
|---|---|---|---|---|---|---|---|---|
| | mefen-triflu- | | dithia- | man- | pro- | | | expected |
| (I-655) | conazole | (15.064) | non | cozeb | pineb | | Efficacy | value |
| (ppm) | (ppm) | (ppm) | (ppm) | (ppm) | (ppm) | Ratio | % | % |
| 0.5 | | | | | | | 0 | |
| 0.1 | | | | | | | 0 | |
| 0.020 | | | | | | | 6 | |
| 0.004 | | | | | | | 7 | |
| | 1.0 | | | | | | 100 | |
| | 0.2 | | | | | | 98 | |
| | 0.04 | | | | | | 87 | |
| | 0.008 | | | | | | 34 | |
| | | 10 | | | | | 100 | |
| | | 2 | | | | | 41 | |
| | | 0.4 | | | | | 0 | |
| | | | 20 | | | | 98 | |
| | | | 4 | | | | 100 | |
| | | | 0.8 | | | | 11 | |
| | | | 0.16 | | | | 13 | |
| | | | | 10 | | | 96 | |
| | | | | 2 | | | 8 | |
| | | | | 0.4 | | | 0 | |
| | | | | | 100.00 | | 33 | |
| | | | | | 20 | | 98 | |
| | | | | | 4 | | 1 | |
| 0.004 | 1.0 | | | | | 1:250 | 100 | 100 |
| 0.004 | 0.2 | | | | | 1:50 | 100 | 99 |
| 0.004 | 0.04 | | | | | 1:10 | 99 | 89 |
| 0.004 | 0.008 | | | | | 1:2 | 100 | 46 |
| 0.5 | | 10 | | | | 1:20 | 100 | 100 |
| 0.5 | | 2 | | | | 1:4 | 100 | 41 |
| 0.5 | | 0.4 | | | | 1:0.8 | 3 | 0 |
| 0.1 | | 10 | | | | 1:100 | 100 | 100 |
| 0.1 | | 2 | | | | 1:20 | 100 | 41 |
| 0.1 | | 0.4 | | | | 1:4 | 2 | 0 |
| 0.020 | | 10 | | | | 1:500 | 100 | 100 |
| 0.020 | | 2 | | | | 1:100 | 100 | 45 |
| 0.020 | | 0.4 | | | | 1:20 | 1 | 6 |
| 0.004 | | 10 | | | | 1:2500 | 100 | 100 |
| 0.004 | | 2 | | | | 1:500 | 100 | 45 |
| 0.004 | | 0.4 | | | | 1:100 | 3 | 7 |
| 0.5 | | | 20 | | | 1:40 | 100 | 98 |
| 0.5 | | | 4 | | | 1:8 | 100 | 100 |
| 0.5 | | | 0.8 | | | 1:1.6 | 47 | 11 |
| 0.5 | | | 0.16 | | | 1:0.32 | 13 | 13 |
| 0.5 | | | | 10 | | 1:20 | 100 | 96 |
| 0.5 | | | | 2 | | 1:4 | 98 | 8 |
| 0.5 | | | | 0.4 | | 1:0.8 | 0 | 0 |
| 0.5 | | | | | 100.00 | 1:200 | 100 | 33 |
| 0.5 | | | | | 20 | 1:40 | 96 | 98 |
| 0.5 | | | | | 4 | 1:8 | 24 | 1 |
| 0.1 | | | | | 100.00 | 1:1000 | 36 | 33 |
| 0.1 | | | | | 20 | 1:200 | 100 | 98 |
| 0.1 | | | | | 4 | 1:40 | 23 | 1 |
| 0.020 | | | | | 100.00 | 1:5000 | 29 | 33 |
| 0.020 | | | | | 20 | 1:1000 | 100 | 98 |
| 0.020 | | | | | 4 | 1:200 | 16 | 1 |
| 0.004 | | | | | 100.00 | 1:25000 | 41 | 33 |
| 0.004 | | | | | 20 | 1:5000 | 100 | 98 |
| 0.004 | | | | | 4 | 1:1000 | 12 | 1 |

TABLE I3
in vitro-Test with Ustilago segetum var. avenae

| | (2.038) | (3.025) | (1.002) | (5.013) | | | Colby |
|---|---|---|---|---|---|---|---|
| | isoflu- | fenpi- | difeno- | man- | | Effi- | ex- |
| (I-746) | cypram | coxamid | conazole | cozeb | | cacy | pected |
| (ppm) | (ppm) | (ppm) | (ppm) | (ppm) | Ratio | % | value % |
| 0.5 | | | | | | 0 | |
| 0.1 | | | | | | 0 | |
| 0.020 | | | | | | 2 | |
| 0.004 | | | | | | 0 | |
| | 1.0 | | | | | 100 | |
| | 0.2 | | | | | 98 | |
| | 0.04 | | | | | 47 | |
| | 0.008 | | | | | 7 | |
| | | 5.0 | | | | 0 | |
| | | 1.0 | | | | 0 | |
| | | 0.2 | | | | 0 | |
| | | 0.04 | | | | 3 | |
| | | | 1.0 | | | 100 | |
| | | | 0.2 | | | 59 | |
| | | | 0.04 | | | 10 | |
| | | | 0.008 | | | 8 | |
| | | | | 10 | | 99 | |
| | | | | 2 | | 0 | |
| | | | | 0.4 | | 0 | |
| | | | | 0.080 | | 0 | |
| 0.5 | 1.0 | | | | 1:2 | 100 | 100 |
| 0.5 | 0.2 | | | | 1:0.4 | 100 | 98 |
| 0.5 | 0.04 | | | | 1:0.08 | 63 | 47 |
| 0.5 | 0.008 | | | | 1:0.016 | 0 | 7 |
| 0.5 | | 5.0 | | | 1:10 | 27 | 0 |
| 0.5 | | 1.0 | | | 1:2 | 46 | 0 |
| 0.5 | | 0.2 | | | 1:0.4 | 2 | 0 |
| 0.5 | | 0.04 | | | 1:0.08 | 3 | 3 |
| 0.5 | | | 1.0 | | 1:2 | 100 | 100 |
| 0.5 | | | 0.2 | | 1:0.4 | 99 | 59 |
| 0.5 | | | 0.04 | | 1:0.08 | 7 | 10 |
| 0.5 | | | 0.008 | | 1:0.016 | 10 | 8 |
| 0.1 | | | 1.0 | | 1:10 | 100 | 100 |
| 0.1 | | | 0.2 | | 1:2 | 98 | 59 |
| 0.1 | | | 0.04 | | 1:0.4 | 16 | 10 |
| 0.1 | | | 0.008 | | 1:0.08 | 13 | 8 |
| 0.5 | | | | 10 | 1:20 | 100 | 99 |
| 0.5 | | | | 2 | 1:4 | 24 | 0 |
| 0.5 | | | | 0.4 | 1:0.8 | 0 | 0 |
| 0.5 | | | | 0.080 | 1:0.16 | 0 | 0 |

TABLE I4
in vitro-Test with Ustilago segetum var. avenae

| | (1.055) | (1.020) | | | | | | Colby |
|---|---|---|---|---|---|---|---|---|
| | mefentriflu- | spiro- | | (5.012) | (5.018) | | | expected |
| (I-746) | conazole | xamine | (15.064) | folpet | propineb | | Efficacy | value |
| (ppm) | (ppm) | (ppm) | (ppm) | (ppm) | (ppm) | Ratio | % | % |
| 0.5 | | | | | | | 0 | |
| 0.1 | | | | | | | 0 | |
| 0.020 | | | | | | | 2 | |
| 0.004 | | | | | | | 0 | |
| | 1.0 | | | | | | 100 | |
| | 0.2 | | | | | | 67 | |
| | 0.008 | | | | | | 5 | |
| | | 20 | | | | | 87 | |
| | | 4 | | | | | 0 | |
| | | 0.8 | | | | | 0 | |
| | | 0.16 | | | | | 0 | |
| | | | 10 | | | | 100 | |
| | | | 2 | | | | 68 | |
| | | | 0.4 | | | | 2 | |
| | | | 0.080 | | | | 1 | |
| | | | | 10 | | | 100 | |
| | | | | 2 | | | 100 | |
| | | | | 0.4 | | | 17 | |
| | | | | 0.08 | | | 12 | |
| | | | | | 100.00 | | 79 | |
| | | | | | 20 | | 100 | |
| | | | | | 4 | | 8 | |
| | | | | | 0.8 | | 4 | |
| 0.5 | 1.0 | | | | | 1:2 | 100 | 100 |
| 0.5 | 0.2 | | | | | 1:0.4 | 95 | 67 |
| 0.5 | 0.008 | | | | | 1:0.016 | 0 | 5 |
| 0.1 | 1.0 | | | | | 1:10 | 100 | 100 |
| 0.1 | 0.2 | | | | | 1:2 | 77 | 67 |
| 0.1 | 0.008 | | | | | 1:0.08 | 0 | 5 |
| 0.020 | 1.0 | | | | | 1:50 | 100 | 100 |
| 0.020 | 0.2 | | | | | 1:10 | 66 | 67 |
| 0.020 | 0.008 | | | | | 1:0.4 | 0 | 5 |
| 0.004 | 1.0 | | | | | 1:250 | 100 | 100 |
| 0.004 | 0.2 | | | | | 1:50 | 98 | 67 |
| 0.004 | 0.008 | | | | | 1:2 | 37 | 5 |
| 0.020 | | 20 | | | | 1:1000 | 99 | 88 |
| 0.020 | | 4 | | | | 1:200 | 0 | 2 |
| 0.020 | | 0.8 | | | | 1:40 | 1 | 2 |
| 0.020 | | 0.16 | | | | 1:8 | 0 | 2 |
| 0.004 | | 20 | | | | 1:5000 | 100 | 87 |
| 0.004 | | 4 | | | | 1:1000 | 0 | 0 |
| 0.004 | | 0.8 | | | | 1:200 | 0 | 0 |
| 0.004 | | 0.16 | | | | 1:40 | 0 | 0 |
| 0.5 | | | 10 | | | 1:20 | 99 | 100 |
| 0.5 | | | 2 | | | 1:4 | 90 | 68 |
| 0.5 | | | 0.4 | | | 1:0.8 | 3 | 2 |
| 0.5 | | | 0.080 | | | 1:0.16 | 0 | 1 |
| 0.1 | | | 10 | | | 1:100 | 100 | 100 |
| 0.1 | | | 2 | | | 1:20 | 100 | 68 |
| 0.1 | | | 0.4 | | | 1:4 | 6 | 2 |
| 0.1 | | | 0.080 | | | 1:0.8 | 0 | 1 |
| 0.020 | | | 10 | | | 1:500 | 100 | 100 |
| 0.020 | | | 2 | | | 1:100 | 96 | 69 |
| 0.020 | | | 0.4 | | | 1:20 | 3 | 4 |
| 0.020 | | | 0.080 | | | 1:4 | 3 | 3 |
| 0.004 | | | 10 | | | 1:2500 | 100 | 100 |
| 0.004 | | | 2 | | | 1:500 | 99 | 68 |
| 0.004 | | | 0.4 | | | 1:100 | 2 | 2 |
| 0.004 | | | 0.080 | | | 1:20 | 0 | 1 |
| 0.5 | | | | 10 | | 1:20 | 100 | 100 |
| 0.5 | | | | 2 | | 1:4 | 100 | 100 |
| 0.5 | | | | 0.4 | | 1:0.8 | 34 | 17 |
| 0.5 | | | | 0.08 | | 1:0.16 | 7 | 12 |
| 0.1 | | | | 10 | | 1:100 | 100 | 100 |
| 0.1 | | | | 2 | | 1:20 | 100 | 100 |
| 0.1 | | | | 0.4 | | 1:4 | 24 | 17 |
| 0.1 | | | | 0.08 | | 1:0.8 | 8 | 12 |
| 0.020 | | | | | 100.00 | 1:5000 | 79 | 80 |
| 0.020 | | | | | 20 | 1:1000 | 100 | 100 |
| 0.020 | | | | | 4 | 1:200 | 18 | 9 |
| 0.020 | | | | | 0.8 | 1:40 | 3 | 5 |
| 0.004 | | | | | 100.00 | 1:25000 | 89 | 81 |
| 0.004 | | | | | 20 | 1:5000 | 99 | 100 |
| 0.004 | | | | | 4 | 1:1000 | 9 | 13 |
| 0.004 | | | | | 0.8 | 1:200 | 5 | 9 |

TABLE I5
in vitro-Test with Ustilago segetum var. avenae

| | (2.038) | (3.020) | (1.002) | | | |
|---|---|---|---|---|---|---|
| | isoflu- | trifloxy- | difeno- | | | Colby |
| (I-749) | cypram | strobin | conazole | | Efficacy | expected |
| (ppm) | (ppm) | (ppm) | (ppm) | Ratio | % | value % |
| 0.5 | | | | | 0 | |
| 0.1 | | | | | 0 | |
| 0.020 | | | | | 0 | |
| 0.004 | | | | | 1 | |
| | 1.0 | | | | 100 | |
| | 0.2 | | | | 100 | |
| | 0.04 | | | | 45 | |
| | 0.008 | | | | 0 | |
| | | 0.2 | | | 53 | |
| | | 0.04 | | | 40 | |
| | | 0.008 | | | 16 | |
| | | | 1.0 | | 100 | |
| | | | 0.2 | | 70 | |
| | | | 0.04 | | 4 | |
| 0.5 | 1.0 | | | 1:2 | 100 | 100 |
| 0.5 | 0.2 | | | 1:0.4 | 100 | 100 |
| 0.5 | 0.04 | | | 1:0.08 | 91 | 45 |
| 0.5 | 0.008 | | | 1:0.016 | 0 | 0 |
| 0.1 | 1.0 | | | 1:10 | 100 | 100 |
| 0.1 | 0.2 | | | 1:2 | 100 | 100 |
| 0.1 | 0.04 | | | 1:0.4 | 69 | 45 |
| 0.1 | 0.008 | | | 1:0.08 | 0 | 0 |
| 0.1 | | 0.2 | | 1:2 | 61 | 53 |
| 0.1 | | 0.04 | | 1:0.4 | 41 | 40 |
| 0.1 | | 0.008 | | 1:0.08 | 21 | 16 |
| 0.5 | | | 1.0 | 1:2 | 100 | 100 |
| 0.5 | | | 0.2 | 1:0.4 | 100 | 70 |
| 0.5 | | | 0.04 | 1:0.08 | 23 | 4 |
| 0.1 | | | 1.0 | 1:10 | 100 | 100 |
| 0.1 | | | 0.2 | 1:2 | 98 | 70 |
| 0.1 | | | 0.04 | 1:0.4 | 12 | 4 |
| 0.020 | | | 1.0 | 1:50 | 100 | 100 |
| 0.020 | | | 0.2 | 1:10 | 74 | 70 |
| 0.020 | | | 0.04 | 1:2 | 1 | 4 |

TABLE I6
in vitro-Test with Ustilago segetum var. avenae

| | | | | | | | Colby |
|---|---|---|---|---|---|---|---|
| | (13.001) | | | (5.018) | | | expec- |
| | fludi- | (5.012) | (5.013) | pro- | | Effi- | ted |
| (I-749) | oxonil | folpet | mancozeb | pineb | | cacy | value |
| (ppm) | (ppm) | (ppm) | (ppm) | (ppm) | Ratio | % | % |
| 0.5 | | | | | | 0 | |
| 0.1 | | | | | | 0 | |
| 0.020 | | | | | | 0 | |
| 0.004 | | | | | | 1 | |
| | 5.0 | | | | | 100 | |
| | 1.0 | | | | | 100 | |
| | 0.2 | | | | | 60 | |
| | 0.04 | | | | | 10 | |
| | | 2 | | | | 100 | |
| | | 0.4 | | | | 7 | |
| | | | 10 | | | 100 | |
| | | | 2 | | | 5 | |
| | | | 0.080 | | | 1 | |
| | | | | 20 | | 100 | |
| | | | | 4 | | 26 | |
| | | | | 0.8 | | 6 | |
| 0.5 | 5.0 | | | | 1:10 | 100 | 100 |
| 0.5 | 1.0 | | | | 1:2 | 100 | 100 |
| 0.5 | 0.2 | | | | 1:0.4 | 100 | 60 |
| 0.5 | 0.04 | | | | 1:0.08 | 0 | 10 |
| 0.5 | | 2 | | | 1:4 | 100 | 100 |
| 0.5 | | 0.4 | | | 1:0.8 | 15 | 7 |
| 0.1 | | 2 | | | 1:20 | 100 | 100 |
| 0.1 | | 0.4 | | | 1:4 | 19 | 7 |
| 0.020 | | 2 | | | 1:100 | 100 | 100 |
| 0.020 | | 0.4 | | | 1:20 | 12 | 7 |
| 0.004 | | 2 | | | 1:500 | 100 | 100 |
| 0.004 | | 0.4 | | | 1:100 | 15 | 7 |
| 0.5 | | | 10 | | 1:20 | 100 | 100 |
| 0.5 | | | 2 | | 1:4 | 59 | 5 |
| 0.5 | | | 0.080 | | 1:0.16 | 0 | 1 |
| 0.1 | | | 10 | | 1:100 | 100 | 100 |
| 0.1 | | | 2 | | 1:20 | 7 | 5 |
| 0.1 | | | 0.080 | | 1:0.8 | 0 | 1 |
| 0.004 | | | 10 | | 1:2500 | 100 | 100 |
| 0.004 | | | 2 | | 1:500 | 10 | 7 |
| 0.004 | | | 0.080 | | 1:20 | 3 | 4 |
| 0.5 | | | | 20 | 1:40 | 100 | 100 |
| 0.5 | | | | 4 | 1:8 | 100 | 26 |
| 0.5 | | | | 0.8 | 1:1.6 | 8 | 6 |
| 0.1 | | | | 20 | 1:200 | 100 | 100 |
| 0.1 | | | | 4 | 1:40 | 67 | 26 |
| 0.1 | | | | 0.8 | 1:8 | 13 | 6 |
| 0.020 | | | | 20 | 1:1000 | 100 | 100 |
| 0.020 | | | | 4 | 1:200 | 62 | 33 |
| 0.020 | | | | 0.8 | 1:40 | 11 | 14 |

1. An active compound combination comprising:
(A) at least one compound of formula (I) 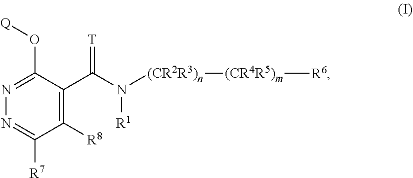
wherein
T is O or S;
n is 0 or 1;
m is 0 or 1;
provided m is 1 when n is 1;
R¹ is selected from the group consisting of hydrogen, hydroxyl, cyano, C₁-C₆-alkyl, C₁-C₆-alkoxy, C₁-C₆-alkoxy-C₁-C₆-alkyl, —C(═O)R^{a1}, —C(═O)(OR^{a1}), —S(═O)R^{a1}, —S(═O)₂R^{a1}, —C(═O)N(R^{a2})₂ and S(═O)₂N(R^{a2})₂ with R^{a1} being selected from the group consisting of C₁-C₆-alkyl, C₁-C₆-haloalkyl, C₃-C₈-cycloalkyl, and C₂-C₆-alkenyl and R^{a2} being selected from the group consisting of hydrogen, C₁-C₆-alkyl, C₁-C₆-haloalkyl, C₃-C₈-cycloalkyl and C₂-C₆-alkenyl;
R² and R³ are independently selected from the group consisting of hydrogen, halogen, cyano, hydroxyl, carboxyl, C₁-C₆-alkyl, C₁-C₆-haloalkyl, C₁-C₆-alkoxy, C₁-C₆-alkoxycarbonyl and C₃-C₈-cycloalkyl, or R² and R³ form, together with the carbon atom to which they are attached to, a C₃-C₈-cycloalkyl or a non-aromatic 3- to 7-membered monocyclic heterocycle;
R⁴ and R⁵ are independently selected from the group consisting of hydrogen, halogen, cyano, hydroxyl, carboxyl, C₁-C₆-alkyl, C₁-C₆-haloalkyl, C₁-C₆-alkoxy, C₁-C₆-alkoxycarbonyl and C₃-C₈-cycloalkyl, or R⁴ and R⁵ form, together with the carbon atom to which they are attached to, a C₃-C₈-cycloalkyl or a non-aromatic 3- to 7-membered monocyclic heterocycle; or
R² and R⁴ form, together with the carbon atom to which they are attached to, a C₃-C₈-cycloalkyl or a non-aromatic 3- to 7-membered monocyclic heterocycle, and R³ and R⁵ are independently hydrogen or halogen; or
R² and R⁴ form together a covalent bond and R³ and R⁵ are independently hydrogen or C₁-C₆-alkyl;
R⁶ is selected from the group consisting of non-aromatic C₃-C₁₂-carbocycle, aromatic C₆-C₁₄-carbocycle, non-aromatic 3- to 14-membered heterocycle, aromatic 5- to 14-membered heterocycle, non-aromatic C₃-C₁₂-carbocyclyloxy, aromatic C₆-C₁₄-carbocyclyloxy, aromatic 5- to 14-membered heterocyclyloxy, non-aromatic 3- to 14-membered heterocyclyloxy, C₁-C₃-alkoxy substituted by a non-aromatic C₃-C₁₂-carbocycle, C₁-C₃-alkoxy substituted by an aromatic C₆-C₁₄-carbocycle, C₁-C₃-alkoxy substituted by a non-aromatic 3- to 14-membered heterocycle, C₁-C₃-alkoxy substituted by an aromatic 5- to 14-membered heterocycle, C₁-C₃-haloalkoxy substituted by a non-aromatic C₃-C₁₂-carbocycle, C₁-C₃-haloalkoxy substituted by an aromatic C₆-C₁₄-carbocycle, C₁-C₃-haloalkoxy substituted by a non-aromatic 3- to 14-membered heterocycle and C₁-C₃-haloalkoxy substituted by an aromatic 5- to 14-membered heterocycle, wherein cyclic, or cyclic moiety of, R⁶ substituents may be substituted with one or more R^{6S} substituents that may be the same or different,
R^{6S} is selected from the group consisting of halogen, cyano, isocyano, nitro, hydroxyl, mercapto, pentafluorosulfanyl, oxo, methylidene, halomethylidene, C₁-C₆-alkyl, C₁-C₆-haloalkyl, C₁-C₆-alkoxy, C₁-C₆-haloalkoxy, C₂-C₆-alkenyl, C₂-C₆-haloalkenyl, C₂-C₆-alkynyl, C₂-C₆-haloalkynyl, C₂-C₆-alkenyloxy, C₂-C₆-haloalkenyloxy, C₁-C₆-alkylsulfanyl, C₁-C₆-haloalkylsulfanyl, C₃-C₈-cycloalkylsulfanyl, C₁-C₆-alkylsulfinyl, C₁-C₆-haloalkylsulfinyl, C₃-C₈-cycloalkylsulfinyl, C₁-C₆-alkylsulfonyl, C₁-C₆-haloalkylsulfonyl, C₃-C₈-cycloalkylsulfonyl, C₃-C₈-cycloalkyl, C₃-C₈-cycloalkyloxy, C₃-C₈-cycloalkenyl, aromatic C₆-C₁₄-carbocycle, aromatic 5- or 6-membered monocyclic heterocycle, non-aromatic 3- to 7-membered monocyclic heterocycle, —N(R^{c})₂, —C(═O)R^{d}, —C(═O)(OR^{d}), —C(═O)N(R^{d})₂, —S(═O)₂N(R^{d})₂, —O—Si(C₁-C₆-alkyl)₃ and —Si(C₁-C₆-alkyl)₃, or two R^{6S} substituents may form, together with the carbon atom to which they are attached to, a C₃-C₈-cycloalkyl,
with R^{c} being independently selected from the group consisting of hydrogen, C₁-C₆-alkyl and C₃-C₈-cycloalkyl,
with R^{d} being independently selected from the group consisting of hydrogen, C₁-C₆-alkyl and C₁-C₆-haloalkyl,
wherein aliphatic R^{6S}, R^{c} and R^{d} substituents may be substituted with one or more substituents independently selected from the group consisting of cyano, hydroxyl, C₁-C₆-alkoxy, C₁-C₆-haloalkoxy, —O—Si(C₁-C₆-alkyl)₃, —Si(C₁-C₆-alkyl)₃, C₃-C₈-cycloalkyl, C₃-C₈-halocycloalkyl and non-aromatic 3- to 7-membered monocyclic heterocycle,
wherein cyclic or cyclic moiety of R^{6S} and cyclic R^{c} substituents may be substituted with one or more substituents independently selected from the group consisting of halogen, cyano, nitro, hydroxyl, formyl, carboxyl, oxo, methylidene, halomethylidene, C₁-C₆-alkyl, C₁-C₆-haloalkyl, C₁-C₆-alkoxy, C₁-C₆-haloalkoxy, C₁-C₆-alkoxycarbonyl, C₁-C₆-haloalkoxycarbonyl, C₂-C₆-alkenyl, C₃-C₈-cycloalkyl and C₃-C₈-halocycloalkyl, and/or cyclic or cyclic moiety of R^{6S} substituents may be substituted with two substituents forming, together with the carbon atom to which they are attached to, a C₃-C₈-cycloalkyl;
R⁷ is selected from the group consisting of hydrogen, halogen, cyano, isocyano, hydroxyl, mercapto, nitro, amino, formyl, C₁-C₆-alkyl, C₁-C₆-haloalkyl, C₁-C₆-hydroxyalkyl, C₁-C₆-alkylcarbonyl, C₁-C₆-haloalkylcarbonyl, C₁-C₆-alkoxy, C₁-C₆-haloalkoxy, C₂-C₆-alkenyl, C₂-C₆-haloalkenyl, C₂-C₆-alkynyl, C₂-C₆-haloalkynyl, C₂-C₆-alkenyloxy, C₂-C₆-haloalkenyloxy, C₂-C₆-alkynyloxy, C₂-C₆-haloalkynyloxy, C₁-C₆-alkylsulfanyl, C₁-C₆-haloalkylsulfanyl, C₃-C₈-cycloalkylsulfanyl, C₁-C₆-alkylsulfinyl, C₁-C₆-haloalkylsulfinyl, C₃-C₈-cycloalkylsulfinyl, C₁-C₆-alkylsulfonyl, C₁-C₆-haloalkylsulfonyl, C₃-C₈-cycloalkylsulfonyl, C₃-C₈-cycloalkyl, C₃-C₆-cycloalkenyl, aromatic C₆-C₁₄-carbocycle, aromatic 5- or 6-membered monocyclic heterocycle, non-aromatic 3- to 7-membered monocyclic heterocycle, C₃-C₈-cycloalkyloxy, aromatic C₆-C₁₄-carbocyclyloxy, aromatic 5- or 6-membered monocyclic heterocyclyloxy, non-aromatic 3- to 7-membered monocyclic heterocyclyloxy, —O—Si(C₁-C₆-alkyl)₃, —Si(C₁-C₆-alkyl)₃, —N(R^{e})₂, —C(═NR^{f})R^{f}, —NR^{g}C(═O)R^{g}, —C(═O)(OR^{g}), —C(═O)N(R^{g})₂, —S(═O)₂N(R^{g})₂ and —S(═O)(═NR^{g})R^{g},
with R^{e} being independently selected from the group consisting of hydrogen, C₁-C₆-alkyl, C₁-C₆-haloalkyl, C₁-C₆-alkoxy, C₂-C₆-alkenyl, C₂-C₆-haloalkenyl, C₂-C₆-alkynyl, C₂-C₆-haloalkynyl, C₃-C₈-cycloalkyl, C₃-C₈-halocycloalkyl, aromatic C₆-C₁₄-carbocycle, aromatic 5- or 6-membered monocyclic heterocycle and non-aromatic 3- to 7-membered monocyclic heterocycle,
with R^{f} being independently selected from the group consisting of hydroxyl, amino, cyano, C₁-C₆-alkyl, C₁-C₆-haloalkyl, C₁-C₆-alkoxy, C₁-C₆-alkylamino and di(C₁-C₆-alkyl)amino,
with R^{g} being independently selected from the group consisting of hydrogen, C₁-C₆-alkyl, C₁-C₆-haloalkyl and C₃-C₈-cycloalkyl,
wherein aliphatic R⁷, R^{e}, R^{f} and R^{g} substituents may be substituted with one or more R^{7Sa} substituents that may be the same or different,
wherein cyclic or cyclic moiety of R⁷, cyclic R^{e} and cyclic R^{g} substituents may be substituted with one or more R^{7Se} substituents that may be the same or different,
R^{7Sa} is selected from the group consisting of cyano, hydroxyl, carboxyl, C₁-C₆-alkoxy, C₁-C₆-haloalkoxy, C₃-C₈-cycloalkyl, C₃-C₈-halocycloalkyl, C₁-C₆-alkoxycarbonyl, —O—Si(C₁-C₆-alkyl)₃, —Si(C₁-C₆-alkyl)₃, aromatic C₆-C₁₄-carbocycle and non-aromatic 3- to 7-membered monocyclic heterocycle,
R^{7Se} is selected from the group consisting of halogen, cyano, nitro, hydroxyl, formyl, oxo, methylidene, halomethylidene, C₁-C₆-alkyl, C₁-C₆-haloalkyl C₁-C₆-alkoxy, C₁-C₆-haloalkoxy, C₂-C₆-alkenyl, C₃-C₈-cycloalkyl, C₃-C₈-halocycloalkyl, —O—Si(C₁-C₆-alkyl)₃ and non-aromatic 3- to 7-membered monocyclic heterocycle, or two R^{7Se} substituents form, together with the carbon atom to which they are attached to, a C₃-C₈-cycloalkyl;
R⁸ is selected from the group consisting of hydrogen, halogen, cyano, isocyano, amino, nitro, hydroxyl, mercapto, carboxyl, C₁-C₆-alkoxycarbonyl, C₁-C₆-alkyl, C₁-C₆-haloalkyl, C₁-C₆-hydroxyalkyl, C₁-C₆-alkoxy, C₁-C₆-haloalkoxy, C₂-C₆-alkenyl, C₂-C₆-haloalkenyl, C₂-C₆-alkynyl, C₂-C₆-haloalkynyl, C₂-C₆-alkenyloxy, C₂-C₆-haloalkenyloxy, C₂-C₆-alkynyloxy, C₂-C₆-haloalkynyloxy, C₁-C₆-alkylsulfanyl, C₁-C₆-haloalkylsulfanyl, C₁-C₆-alkylsulfinyl, C₁-C₆-haloalkylsulfinyl, C₁-C₆-alkylsulfonyl, C₁-C₆-haloalkyl-sulfonyl, C₃-C₈-cycloalkyl, C₃-C₆-cycloalkenyl, aromatic C₆-C₁₄-carbocycle, non-aromatic 3- to 14-membered heterocycle, aromatic 5- to 14-membered heterocycle, C₃-C₈-cycloalkyloxy, aromatic C₆-C₁₄-carbocyclyloxy, non-aromatic 3- to 14-membered heterocyclyloxy, aromatic 5- to 14-membered heterocyclyloxy, —O—Si(C₁-C₆-alkyl)₃, —Si(C₁-C₆-alkyl)₃, —N(R^{h})₂, —SRⁱ, —S(═O)Rⁱ and —S(═O)₂Rⁱ,
with R^{h} being independently selected from the group consisting of hydrogen, C₁-C₆-alkyl, C₁-C₆-haloalkyl, C₁-C₆-alkoxy, C₂-C₆-alkenyl, C₂-C₆-haloalkenyl, C₂-C₆-alkynyl, C₂-C₆-haloalkynyl, C₃-C₈-cycloalkyl, C₃-C₈-halocycloalkyl, aromatic C₆-C₁₄-carbocycle, aromatic 5- to 14-membered heterocycle and non-aromatic 3- to 7-membered monocyclic heterocycle,
with Rⁱ being selected from the group consisting of C₂-C₆-alkenyl, C₂-C₆-haloalkenyl, C₂-C₆-alkynyl, C₂-C₆-haloalkynyl, C₃-C₈-cycloalkyl, C₃-C₈-halocycloalkyl, aromatic C₆-C₁₄-carbocycle, aromatic 5- to 14-membered heterocycle and non-aromatic 3- to 7-membered monocyclic heterocycle,
wherein aliphatic R⁸, R^{h} and Rⁱ substituents may be substituted with one or more R^{8Sa} substituents that may be the same or different,
wherein cyclic or cyclic moiety of R⁸, cyclic R^{h} and cyclic Rⁱ substituents may be substituted with one or more R^{8Sc} substituents that may be the same or different,
R^{8Sa} is selected from the group consisting of cyano, amino, nitro, hydroxyl, formyl, carboxyl, C₁-C₆-alkoxy, C₁-C₆-haloalkoxy, C₁-C₆-alkoxy-C₁-C₆-alkoxy, C₁-C₆-alkoxycarbonyl, C₁-C₆-haloalkoxycarbonyl, C₁-C₆-alkylcarbonyl, C₁-C₆-haloalkylcarbonyl, C₃-C₈-cycloalkyl, C₃-C₈-halocycloalkyl, C₁-C₆-alkylsulfanyl, C₁-C₆-haloalkylsulfanyl, C₁-C₆-alkylsulfinyl, C₁-C₆-haloalkylsulfinyl, C₁-C₆-alkylsulfonyl, C₁-C₆-haloalkylsulfonyl, —O—Si(C₁-C₆-alkyl)₃, —Si(C₁-C₆-alkyl)₃, non-aromatic 3- to 7-membered monocyclic heterocycle and —N(R^{a′})₂ with R^{a′} being independently selected from the group consisting of hydrogen, formyl, C₁-C₆-alkyl, C₁-C₆-haloalkyl, C₃-C₈-cycloalkyl and C₁-C₆-alkylcarbonyl, wherein said non-aromatic 3- to 7-membered monocyclic heterocycle R^{8Sa} may be substituted with one or more C₁-C₆-alkyl substituents that may be the same or different,
R^{8Sc} is selected from the group consisting of halogen, cyano, amino, nitro, hydroxyl, formyl, carboxyl, oxo, methylidene, halomethylidene, C₁-C₆-alkyl, C₁-C₆-haloalkyl, C₁-C₆-alkoxy, C₁-C₆-haloalkoxy, C₁-C₆-alkoxycarbonyl, C₁-C₆-haloalkoxycarbonyl, C₂-C₆-alkenyl, C₁-C₆-alkylsulfanyl, C₁-C₆-alkylsulfinyl, C₁-C₆-alkylsulfonyl, C₃-C₈-cycloalkyl, C₃-C₈-halocycloalkyl, —O—Si(C₁-C₆-alkyl)₃ and non-aromatic 3- to 7-membered monocyclic heterocycle that may be substituted with one or more C₁-C₆-alkyl substituents that may be the same or different, or two R^{8Sc} substituents form, together with the carbon atom to which they are attached to, a C₃-C₈-cycloalkyl or a non-aromatic 3- to 7-membered monocyclic heterocycle, wherein said non-aromatic 3- to 7-membered monocyclic heterocycle may be substituted with one or more C₁-C₆-alkyl substituents that may be the same or different;
Q is selected from the group consisting of aromatic C₆-C₁₄-carbocycle, non-aromatic C₃-C₁₂-carbocycle, non-aromatic 3- to 14-membered heterocycle and aromatic 5- to 14-membered heterocycle, wherein any of said carbocycle or heterocycle groups may be substituted with one or more Q^{S} substituents that may be the same or different,
Q^{S} is selected from the group consisting of halogen, cyano, isocyano, nitro, hydroxyl, mercapto, formyl, carboxyl, C₁-C₆-alkyl, C₁-C₆-haloalkyl, C₁-C₆-alkylcarbonyl, C₁-C₆-haloalkylcarbonyl, C₁-C₆-alkoxy, C₁-C₆-haloalkoxy, C₁-C₆-alkoxy-C₁-C₆-alkyl, C₁-C₆-alkoxycarbonyl, C₁-C₆-haloalkoxycarbonyl, C₂-C₆-alkenyl, C₂-C₆_haloalkenyl, C₂-C₆-alkynyl, C₂-C₆-haloalkynyl, C₂-C₆-alkenyloxy, C₂-C₆-haloalkenyloxy, C₁-C₆-alkylsulfanyl, C₁-C₆-haloalkylsulfanyl, C₁-C₆-alkylsulfinyl, C₁-C₆-haloalkylsulfinyl, C₁-C₆-alkylsulfonyl, C₁-C₆-haloalkylsulfonyl, C₃-C₈-cycloalkyl, C₃-C₈-cycloalkyloxy, C₃-C₆-cycloalkenyl, non-aromatic 3- to 7-membered monocyclic heterocycle, aromatic 5- to 14-membered heterocycle, —O—Si(C₁-C₆-alkyl)₃, —Si(C₁-C₆-alkyl)₃, —O—C(═O)R^{j}, —NR^{j}C(═O)R^{j}, —C(═O)N(R^{j})₂, —C(═S)R^{j}, —C(═S)N(R^{j})₂, —C(═NR^{j})R^{j} and —C(═NOR^{j})R^{j} and —N(R^{k})₂
with R^{j} being independently selected from the group consisting of hydrogen, C₁-C₆-alkyl, C₁-C₆-haloalkyl and C₁-C₆-alkoxy,
with R^{k} being independently selected from the group consisting of hydrogen, hydroxyl, C₁-C₆-alkyl, C₁-C₆-haloalkyl, C₁-C₆-alkoxy, C₂-C₆-alkenyl, C₂-C₆-haloalkenyl and C₃-C₈-cycloalkyl,
wherein aliphatic Q^{S}, R^{j} and R^{k} substituents may be substituted with one or more substituents independently selected from the group consisting of cyano, amino, nitro, hydroxyl, C₁-C₆-alkoxy, C₁-C₆-haloalkoxy, C₁-C₆-alkoxycarbonyl, C₁-C₆-haloalkoxycarbonyl, C₃-C₈-cycloalkyl, C₃-C₈-halocycloalkyl, —Si(C₁-C₆-alkyl)₃ and non-aromatic 3- to 7-membered monocyclic heterocycle,
wherein cyclic or cyclic moiety of Q^{S} and cyclic R^{k} substituents may be substituted with one or more R^{Qs} substituents independently selected from the group consisting of halogen, cyano, amino, nitro, hydroxyl, formyl, carboxyl, oxo, methylidene, halomethylidene, C₁-C₆-alkyl, C₁-C₆-haloalkyl, C₁-C₆-alkoxy, C₁-C₆-haloalkoxy, C₁-C₆-alkoxycarbonyl, C₁-C₆-haloalkoxycarbonyl, C₃-C₈-cycloalkyl, C₃-C₈-halocycloalkyl, C₂-C₆-alkenyl and non-aromatic 3- to 7-membered monocyclic heterocycle, wherein cyclic R^{Qs} substituents may be substituted with two substituents forming, together with the carbon atom to which they are attached to, a C₃-C₈-cycloalkyl,
provided that compound of formula (I) is not:
(a) 3-(1H-benzotriazol-1-yloxy)-N-(4-tert-butylphenyl)-6-chloropyridazine-4-carboxamide ([561297-99-2]);
(b) 3-(cyclopentyloxy)-6-(4-fluorophenoxy)-N-{[(3R)-1-isopropylpiperidin-3-yl]methyl}pyridazine-4-carboxamide ([1336909-91-1]);
(c) 6-(4-fluorophenoxy)-N-{[(3R)-1-isopropylpiperidin-3-yl]methyl}-3-(tetrahydro-2H-pyran-4-yloxy)pyridazine-4-carboxamide ([1336909-90-0]);
(d) 6-chloro-N-{[(3R)-1-isopropylpiperidin-3-yl]methyl}-3-(tetrahydro-2H-pyran-4-yloxy)pyridazine-4-carboxamide ([1336910-48-5]);
(e) 6-chloro-3-(cyclopentyloxy)-N-{[(3R)-1-isopropylpiperidin-3-yl]methyl}pyridazine-4-carboxamide ([1336910-49-6]);
(f) 3-(1H-benzotriazol-1-yloxy)-6-chloro-N-(cyclohexylmethyl)pyridazine-4-carboxamide ([1202404-84-9]),
and
(B) at least one further active compound selected from
(1) inhibitors of the ergosterol synthesis,
(2) inhibitors of the respiratory chain at complex I or II,
(3) inhibitors of the respiratory chain at complex III,
(4) inhibitors of the mitosis and cell division,
(5) compounds capable of having a multisite action,
(6) compounds capable of inducing a host defense,
(7) inhibitors of the amino acid and/or protein biosynthesis,
(8) inhibitors of the ATP production,
(9) inhibitors of the cell wall synthesis,
(10) inhibitors of the lipid and membrane synthesis,
(11) inhibitors of the melanine biosynthesis,
(12) inhibitors of the nucleic acid synthesis,
(13) inhibitors of the signal transduction,
(14) compounds capable of acting as uncoupler,
(15) other fungicides,
(16) antibacterial agents
(17) biological fungicides
(18) fatty acids or derivatives thereof.

2. The active compound combination according to claim 1, wherein the compound of formula (I) is a compound of formula (I) wherein
T is O;
n is 0 or 1;
m is 0 or 1;
provided m is 1 when n is 1;
R¹ is selected from the group consisting of hydrogen, hydroxyl, C₁—C-alkyl and —C(═O)(OR^{a1}), with R^{a1} being selected from the group consisting of C₁-C₄-alkyl and C₂-C₄-alkenyl,
R² and R³ are hydrogen, or R² and R³ form, together with the carbon atom to which they are attached to, a C₃-C₆-cycloalkyl,
R⁴ and R⁵ are independently selected from the group consisting of hydrogen, fluorine, chlorine and C₁-C₄-alkyl, or R⁴ and R⁵ form, together with the carbon atom to which they are attached to, a C₃-C₆-cycloalkyl; or
R² and R⁴ form, together with the carbon atom to which they are attached to, a C₃-C₆-cycloalkyl, and R³ and R⁵ are independently hydrogen or halogen; or
R⁶ is selected from the group consisting of an indanyl, a 1,2,3,4-tetrahydronaphthalenyl, a spiro[cyclopropane-1,2′-indane]-1-yl, phenyl, naphthyl, a 4- to 6-membered monocyclic non-aromatic heterocycle fused to a phenyl, a 5- or 6-membered monocyclic heteroaryl fused to a monocyclic C₃-C₈-cycloalkyl, an aromatic 5- or 6-membered monocyclic heterocycle, a 5- or 6-membered monocyclic aromatic heterocycle fused to an aryl, phenoxy, benzyloxy or —OCF₂-phenyl, wherein cyclic, or cyclic moiety of, R⁶ substituents may be substituted by one to three R^{6S} substituents selected from the group consisting of fluorine, chlorine, cyano, C₁-C₄-alkyl, C₁-C₄-haloalkyl, C₁-C₄-alkoxy, C₁-C₄-haloalkoxy, C₂-C₆-alkenyl, C₂-C₆-alkynyl, C₁-C₄-haloalkylsulfanyl, C₃-C₆-cycloalkyl, phenyl, pyridyl, pyrazolyl, imidazolyl, triazolyl, oxetanyl and tetrahydrofuranyl,
wherein cyclic or cyclic moiety of R^{6S} substituents may be substituted with one to three substituents independently selected from the group consisting of fluorine, chlorine, C₁-C₄-alkyl, C₁-C₄-haloalkyl and C₁-C₄-alkoxycarbonyl,
R⁷ is selected from the group consisting of hydrogen, chlorine, C₁-C₄-alkyl, C₁-C₄-haloalkyl, C₁-C₄-hydroxyalkyl, C₁-C₄-alkylcarbonyl, C₁-C₄-alkoxy, C₂-C₆-alkenyl, C₂-C₆-alkynyl, C₃-C₆-cycloalkyl, pyridinyl, imidazolyl, pyrazolyl, oxetanyl, tetrahydrofuranyl, tetrahydropyranyl, pyrrolidinyl, azetidinyl and —N(R^{e})₂,
with R^{e} being independently selected from the group consisting of hydrogen, C₁-C₄-alkyl and C₃-C₆-cycloalkyl,
wherein aliphatic R⁷ and R^{e} substituents may be substituted with one or two R^{7Sa} substituents independently selected from the group consisting of C₁-C₄-alkoxy, C₃-C₆-cycloalkyl, C₁-C₂-alkoxycarbonyl and phenyl,
wherein cyclic or cyclic moiety of R⁷ and cyclic R^{e} may be substituted with one or two R^{7Sc} substituents independently selected from the group consisting of fluorine, chlorine, hydroxyl, C₁-C₄-alkyl and C₁-C₄-alkoxy,
R⁸ is selected from the group consisting of hydrogen, halogen, hydroxyl, C₁-C₄-alkyl, C₁-C₄-haloalkyl, C₁-C₄-alkoxy, C₂-C₆-alkenyl, C₂-C₆-alkenyloxy, C₂-C₆-haloalkenyloxy, C₁-C₄-alkylsulfanyl, C₁-C₄-haloalkylsulfanyl, C₁-C₄-alkylsulfinyl, C₁-C₄-alkylsulfonyl, C₃-C₆-cycloalkyl, phenyl, non-aromatic 3- to 7-membered heterocycle, aromatic 5- or 6-membered heterocycle, non-aromatic 3- to 7-membered heterocyclyloxy and —N(R^{h})₂,
with R^{h} being independently selected from the group consisting of hydrogen, C₁-C₄-alkyl, C₂-C₆-alkenyl, C₃-C₆-cycloalkyl, phenyl and non-aromatic 3- to 7-membered monocyclic heterocycle,
wherein aliphatic R⁸ and R^{h} substituents may be substituted with one to three R^{8Sa} substituents independently selected from the group consisting of hydroxyl, carboxyl, C₁-C₄-alkoxy, C₁-C₄-alkoxy-C₁-C₄-alkoxy, C₁-C₄-alkoxycarbonyl, C₃-C₆-cycloalkyl, non-aromatic 3- to 7-membered monocyclic heterocycle and —N(R^{a′})₂ with R^{a′} being independently selected from the group consisting of hydrogen, C₁-C₄-alkyl and C₁-C₂-alkylcarbonyl,
wherein cyclic or cyclic moiety of R⁸ and cyclic R^{h} substituents may be substituted with one to three R^{8Sc} substituents independently selected from the group consisting of chlorine, cyano, hydroxyl, C₁-C₄-alkyl, C₁-C₄-haloalkyl, C₁-C₄-alkoxy, C₁-C₄-alkoxycarbonyl, C₃-C₆-cycloalkyl, oxolanyl, oxetanyl and tetrahydrofuranyl, or two R^{8Sc} substituents form, together with the carbon atom to which they are attached to a oxetanyl or oxiranyl,
Q is selected from the group consisting of phenyl, naphth-2-yl, bicyclo[4.2.0]octa-1(6), 2,4-trienyl, indanyl, 1,2,3,4-tetrahydronaphthalenyl, indenyl, dihydronaphthalenyl, bicyclo[4.2.0]octa-1(6),2,4-trienyl, 2,3-dihydrobenzofuranyl, 1,3-dihydroisobenzofuranyl, indolinyl, 1,3-benzodioxolyl, chromanyl, 2,3-dihydro-1,4-benzodioxinyl, [1,3]dioxolo[4,5-b]pyridinyl, 5,6,7,8-tetrahydroquinolinyl, 6,7-dihydro-5H-cyclopenta[b]pyridinyl, 1,3-benzodioxolyl, 2,3-dihydrobenzofuranyl, pyrrolyl, furanyl, thienyl, imidazolyl, triazolyl, oxazolyl, thiazolyl, pyridinyl, pyridazinyl and pyrimidinyl, indolyl, benzimadozolyl, indazolyl, benzofuranyl, benzothiophenyl, benzothiazolyl, benzoxazolyl, quinolinyl, furo[3,2-b]pyridinyl, thieno[3,2-b]thiophenyl and thieno[2,3-d]thiazolyl,
wherein any of said carbocycle or heterocycle groups may be substituted with one to three Q^{S} substituents independently selected from the group consisting of halogen, C₁-C₄-alkyl, C₁-C₄-haloalkyl, C₁-C₄-alkoxy, C₁-C₄-haloalkoxy, C₂-C₄-alkenyl, C₂-C₄-alkynyl, C₁-C₄-alkylsulfanyl, C₁-C₄-haloalkylsulfanyl, C₃-C₆-cycloalkyl, oxiranyl, oxetanyl and —N(R^{k})₂
with R^{k} being hydrogen,
wherein cyclic or cyclic moiety of Q^{S} substituents may be substituted with one or two R^{Qs} substituents independently selected from the group consisting of fluorine and chlorine.

3. The active compound combination according to claim 1, wherein the compound of formula (I) is a compound of formula (I), wherein
T is O
R¹ is hydrogen,
R² and R³, when present (i.e. n=1), are hydrogen, or R² and R³ form, together with the carbon atom to which they are attached to, a cyclopropyl or cyclobutyl,
R⁴ and R⁵, when present (i.e. m=1), are independently selected from the group consisting of hydrogen and halogen,
R⁶ is indanyl, 1,2,3,4-tetrahydronaphthalenyl, spiro[cyclopropane-1,2′-indane]-1-yl, phenyl, 2,3-dihydrobenzofuranyl, 1,3-benzodioxolyl, 2,3-dihydro-1,4-benzodioxinyl, 4,5,6,7-tetrahydrobenzothiophenyl, thienyl, pyridinyl, indolyl, benzoxazolyl, quinolinyl or isoquinolinyl,
wherein said indanyl, a 1,2,3,4-tetrahydronaphthalenyl, spiro[cyclopropane-1,2′-indane]-1-yl, phenyl, 2,3-dihydrobenzofuranyl, 1,3-benzodioxolyl, 2,3-dihydro-1,4-benzodioxinyl, 4,5,6,7-tetrahydrobenzothiophenyl, thienyl, pyridinyl indolyl, benzoxazolyl, quinolinyl or isoquinolinyl may be substituted by one to three R^{6S} substituents independently selected from the group consisting of halogen, cyano, C₁-C₆-alkyl, C₁-C₆-haloalkyl, C₁-C₆-alkoxy, C₁-C₆-haloalkoxy, C₂-C₆-alkenyl, C₂-C₆-alkynyl, cyclopropyl,
R⁷ is hydrogen, halogen, cyano, C₁-C₄-alkyl, C₁-C₄-haloalkyl, C₁-C₄-hydroxyalkyl, C₁-C₄-alkylcarbonyl, C₁-C₄-alkoxy, C₂-C₆-alkenyl, C₂-C₆-alkynyl or cyclopropyl,
wherein aliphatic R⁷ may be substituted by one or two R^{7Sa} substituents methoxy
R⁸ is hydrogen, halogen, C₁-C₄-alkyl, C₁-C₄-alkoxy, C₂-C₄-alkenyl, C₁-C₄-alkylsulfanyl, pyrazolyl, imidazolyl, thiazolyl, pyridinyl or —N(R^{h})₂,
wherein R^{h} is independently selected from the group consisting of hydrogen, C₁-C₄-alkyl and cyclopropyl,
wherein said aliphatic R⁸ substituents may be substituted by one or two Rasa substituents independently selected from the group consisting of C₁-C₄-haloalkyl, C₁-C₄-alkoxy, C₁-C₄-alkoxy-C₁-C₂-alkoxy, cyclopropyl and cyclobutyl,
wherein said cyclic R⁸ substituents may be substituted by one or two R^{8Sc} substituents independently selected from the group consisting of halogen,
Q is phenyl, thienyl or pyridinyl,
wherein said phenyl, thienyl and pyridinyl may be substituted by one to three Q^{S} substituents independently selected from the group consisting of halogen, C₁-C₄-alkyl, C₁-C₄-haloalkyl, C₁-C₄-alkoxy, C₁-C₄-haloalkoxy, C₂-C₄-alkenyl, C₂-C₄-alkynyl, C₁-C₄-alkylsulfanyl, C₁-C₄-haloalkylsulfanyl, cyclopropyl, cyclobutyl, oxiranyl and oxetanyl.

4. The active compound combination according to claim 1, wherein the compound of formula (I) selected from the group consisting of (I-655) 6-chloro-3-(3-cyclopropyl-2-fluorophenoxy)-N-[2-(2,4-dimethylphenyl)-2,2-difluoroethyl]-5-methylpyridazine-4-carboxamide, (I-667) 3-(3-bromo-2-fluorophenoxy)-6-chloro-N-[2-(2-chloro-4-methylphenyl)-2,2-difluoroethyl]-5-methylpyridazine-4-carboxamide, (I-746) 6-chloro-N-[2-(2-chloro-4-methylphenyl)-2,2-difluoroethyl]-3-(3-cyclopropyl-2-fluoro-phenoxy)-5-methylpyridazine-4-carboxamide, (I-749) 6-chloro-3-(3-cyclopropyl-2-fluorophenoxy)-N-[2-(3,4-dimethylphenyl)-2,2-difluoroethyl]-5-methylpyridazine-4-carboxamide, (I-784) 6-chloro-3-(3-chloro-2-fluorophenoxy)-N-[2-(2,4-dimethylphenyl)-2,2-difluoroethyl]-5-methylpyridazine-4-carboxamide, (I-840) N-[2-(2-bromo-4-methylphenyl)-2,2-difluoroethyl]-6-chloro-3-(3-cyclopropyl-2-fluorophenoxy)-5-methylpyridazine-4-carboxamide.

5. The active compound combination according to claim 1, wherein the further active compound is selected from the group consisting of (1.001) cyproconazole, (1.002) difenoconazole, (1.003) epoxiconazole, (1.004) fenhexamid, (1.005) fenpropidin, (1.006) fenpropimorph, (1.007) fenpyrazamine, (1.008) fluquinconazole, (1.009) flutriafol, (1.010) imazalil, (1.011) imazalil sulfate, (1.012) ipconazole, (1.013) metconazole, (1.014) myclobutanil, (1.015) paclobutrazol, (1.016) prochloraz, (1.017) propiconazole, (1.018) prothioconazole, (1.019) pyrisoxazole, (1.020) spiroxamine, (1.021) tebuconazole, (1.022) tetraconazole, (1.023) triadimenol, (1.024) tridemorph, (1.025) triticonazole, (1.026) (1R,2S,5S)-5-(4-chlorobenzyl)-2-(chloromethyl)-2-methyl-1-(1H-1,2,4-triazol-1-ylmethyl)cyclopentanol, (1.027) (1S,2R,5R)-5-(4-chlorobenzyl)-2-(chloromethyl)-2-methyl-1-(1H-1,2,4-triazol-1-ylmethyl)cyclopentanol, (1.028) (2R)-2-(1-chlorocyclopropyl)-4-[(1R)-2,2-dichlorocyclopropyl]-1-(1H-1,2,4-triazol-1-yl)butan-2-ol, (1.029) (2R)-2-(1-chloro-cyclopropyl)-4-[(1S)-2,2-dichlorocyclopropyl]-1-(1H-1,2,4-triazol-1-yl)butan-2-ol, (1.030) (2R)-2-[4-(4-chlorophenoxy)-2-(trifluoromethyl)phenyl]-1-(1H-1,2,4-triazol-1-yl)propan-2-ol, (1.031) (2S)-2-(1-chlorocyclopropyl)-4-[(1R)-2,2-dichlorocyclopropyl]-1-(1H-1,2,4-triazol-1-yl)butan-2-ol, (1.032) (2S)-2-(1-chlorocyclopropyl)-4-[(1S)-2,2-dichlorocyclopropyl]-1-(1H-1,2,4-triazol-1-yl)butan-2-ol, (1.033) (2S)-2-[4-(4-chlorophenoxy)-2-(trifluoromethyl)phenyl]-1-(1H-1,2,4-triazol-1-yl)propan-2-ol, (1.034) (R)-[3-(4-chloro-2-fluorophenyl)-5-(2,4-difluorophenyl)-1,2-oxazol-4-yl](pyridin-3-yl)methanol, (1.035) (S)-[3-(4-chloro-2-fluorophenyl)-5-(2,4-difluorophenyl)-1,2-oxazol-4-yl](pyridin-3-yl)methanol, (1.036) [3-(4-chloro-2-fluorophenyl)-5-(2,4-difluorophenyl)-1,2-oxazol-4-yl](pyridin-3-yl)methanol, (1.037) 1-({(2R,4S)-2-[2-chloro-4-(4-chlorophenoxy)phenyl]-4-methyl-1,3-dioxolan-2-yl}methyl)-1H-1,2,4-triazole, (1.038) 1-({(2S,4S)-2-[2-chloro-4-(4-chlorophenoxy)phenyl]-4-methyl-1,3-dioxolan-2-yl}methyl)-1H-1,2,4-triazole, (1.039) 1-{[3-(2-chlorophenyl)-2-(2,4-difluorophenyl)oxiran-2-yl]methyl}-1H-1,2,4-triazol-5-yl thiocyanate, (1.040) 1-{[rel(2R,3R)-3-(2-chlorophenyl)-2-(2,4-difluorophenyl)oxiran-2-yl]methyl}-1H-1,2,4-triazol-5-yl thiocyanate, (1.041) 1-{[rel(2R,3S)-3-(2-chlorophenyl)-2-(2,4-difluorophenyl)oxiran-2-yl]methyl}-1H-1,2,4-triazol-5-yl thiocyanate, (1.042) 2-[(2R,4R,5R)-1-(2,4-dichlorophenyl)-5-hydroxy-2,6,6-trimethylheptan-4-yl]-2,4-dihydro-3H-1,2,4-triazole-3-thione, (1.043) 2-[(2R,4R,5S)-1-(2,4-dichlorophenyl)-5-hydroxy-2,6,6-trimethylheptan-4-yl]-2,4-dihydro-3H-1,2,4-triazole-3-thione, (1.044) 2-[(2R,4S,5R)-1-(2,4-dichlorophenyl)-5-hydroxy-2,6,6-trimethylheptan-4-yl]-2,4-dihydro-3H-1,2,4-triazole-3-thione, (1.045) 2-[(2R,4S,5S)-1-(2,4-dichlorophenyl)-5-hydroxy-2,6,6-trimethylheptan-4-yl]-2,4-dihydro-3H-1,2,4-triazole-3-thione, (1.046) 2-[(2S,4R,5R)-1-(2,4-dichlorophenyl)-5-hydroxy-2,6,6-trimethylheptan-4-yl]-2,4-dihydro-3H-1,2,4-triazole-3-thione, (1.047) 2-[(2S,4R,5S)-1-(2,4-dichlorophenyl)-5-hydroxy-2,6,6-trimethylheptan-4-yl]-2,4-dihydro-3H-1,2,4-triazole-3-thione, (1.048) 2-[(2S,4S,5R)-1-(2,4-dichlorophenyl)-5-hydroxy-2,6,6-trimethylheptan-4-yl]-2,4-dihydro-3H-1,2,4-triazole-3-thione, (1.049) 2-[(2S,4S,5S)-1-(2,4-dichlorophenyl)-5-hydroxy-2,6,6-trimethylheptan-4-yl]-2,4-dihydro-3H-1,2,4-triazole-3-thione, (1.050) 2-[1-(2,4-dichlorophenyl)-5-hydroxy-2,6,6-trimethylheptan-4-yl]-2,4-dihydro-3H-1,2,4-triazole-3-thione, (1.051) 2-[2-chloro-4-(2,4-dichlorophenoxy)phenyl]-1-(1H-1,2,4-triazol-1-yl)propan-2-ol, (1.052) 2-[2-chloro-4-(4-chlorophenoxy)phenyl]-1-(1H-1,2,4-triazol-1-yl)butan-2-ol, (1.053) 2-[4-(4-chlorophenoxy)-2-(trifluoromethyl)phenyl]-1-(1H-1,2,4-triazol-1-yl)butan-2-ol, (1.054) 2-[4-(4-chlorophenoxy)-2-(trifluoromethyl)phenyl]-1-(1H-1,2,4-triazol-1-yl)pentan-2-ol, (1.055) mefentrifluconazole, (1.056) 2-{[3-(2-chlorophenyl)-2-(2,4-difluorophenyl)oxiran-2-yl]methyl}-2,4-dihydro-3H-1,2,4-triazole-3-thione, (1.057) 2-{[rel(2R,3R)-3-(2-chlorophenyl)-2-(2,4-difluorophenyl)oxiran-2-yl]methyl}-2,4-dihydro-3H-1,2,4-triazole-3-thione, (1.058) 2-{[rel(2R,3S)-3-(2-chlorophenyl)-2-(2,4-difluorophenyl)oxiran-2-yl]methyl}-2,4-dihydro-3H-1,2,4-triazole-3-thione, (1.059) 5-(4-chlorobenzyl)-2-(chloromethyl)-2-methyl-1-(1H-1,2,4-triazol-1-ylmethyl)cyclopentanol, (1.060) 5-(allylsulfanyl)-1-{[3-(2-chloro-phenyl)-2-(2,4-difluorophenyl)oxiran-2-yl]methyl}-1H-1,2,4-triazole, (1.061) 5-(allylsulfanyl)-1-{[rel(2R,3R)-3-(2-chlorophenyl)-2-(2,4-difluorophenyl)oxiran-2-yl]methyl}-1H-1,2,4-triazole, (1.062) 5-(allylsulfanyl)-1-{[rel(2R,3S)-3-(2-chlorophenyl)-2-(2,4-difluorophenyl)oxiran-2-yl]methyl}-1H-1,2,4-triazole, (1.063) N′-(2,5-dimethyl-4-{[3-(1,1,2,2-tetrafluoro-ethoxy)phenyl]sulfanyl}phenyl)-N-ethyl-N-methylimidoformamide, (1.064) N′-(2,5-dimethyl-4-{[3-(2,2,2-trifluoroethoxy)phenyl]sulfanyl}phenyl)N-ethyl-N-methylimidoformamide, (1.065) N′-(2,5-dimethyl-4-{[3-(2,2,3,3-tetrafluoropropoxy)phenyl]sulfanyl}phenyl)-N-ethyl-N-methylimidoformamide, (1.066) N′(2,5-dimethyl-4-{[3-(pentafluoroethoxy)phenyl]sulfanyl}phenyl)-N-ethyl-N-methylimidoformamide, (1.067) N′-(2,5-dimethyl-4-{3-[(1,1,2,2-tetrafluoroethyl)sulfanyl]-phenoxy}phenyl)-N-ethyl-N-methylimidoformamide, (1.068) N′-(2,5-dimethyl-4-{3-[(2,2,2-trifluoroethyl)sulfanyl]phenoxy}phenyl)-N-ethyl-N-methylimidoformamide, (1.069) N′-(2,5-dimethyl-4-{3-[(2,2,3,3-tetrafluoropropyl)sulfanyl]phenoxy}phenyl)-N-ethyl-N-methylimidoformamide, (1.070) N′-(2,5-dimethyl-4-{3-[(penta-fluoroethyl)sulfanyl]phenoxy}phenyl)-N-ethyl-N-methylimidoformamide, (1.071) N′-(2,5-dimethyl-4-phenoxyphenyl)-N-ethyl-N-methylimidoformamide, (1.072) N′-(4-{[3-(difluoro-methoxy)phenyl]sulfanyl}-2,5-dimethylphenyl)-N-ethyl-N-methylimidoformamide, (1.073) N′-(4-{3-[(difluoromethyl)sulfanyl]phenoxy}-2,5-dimethylphenyl)-N-ethyl-N-methylimidoformamide, (1.074) N′-[5-bromo-6-(2,3-dihydro-1H-inden-2-yloxy)-2-methylpyridin-3-yl]-N-ethyl-N-methylimidoformamide, (1.075) N′-{4-[(4,5-dichloro-1,3-thiazol-2-yl)oxy]-2,5-dimethylphenyl}-N-ethyl-N-methylimidoformamide, (1.076) N′-{5-bromo-6-[(1R)-1-(3,5-difluorophenyl)ethoxy]-2-methyl-pyridin-3-yl}-N-ethyl-N-methylimidoformamide, (1.077) N′-{5-bromo-6-[(1S)-1-(3,5-difluoro-phenyl)ethoxy]-2-methylpyridin-3-yl}-N-ethyl-N-methylimidoformamide, (1.078) N′-{5-bromo-6-[(cis-4-isopropylcyclohexyl)oxy]-2-methylpyridin-3-yl}-N-ethyl-N-methylimidoformamide, (1.079) N′-{5-bromo-6-[(trans-4-isopropylcyclohexyl)oxy]-2-methylpyridin-3-yl}-N-ethyl-N-methylimidoformamide, (1.080) N′-{5-bromo-6-[1-(3,5-difluorophenyl)ethoxy]-2-methylpyridin-3-yl}-N-ethyl-N-methylimidoformamide, (1.081) ipfentrifluconazole, (1.082) 2-[4-(4-chlorophenoxy)-2-(trifluoromethyl)phenyl]-1-(1H-1,2,4-triazol-1-yl)propan-2-ol, (1.083) 2-[6-(4-bromophenoxy)-2-(trifluoromethyl)-3-pyridyl]-1-(1,2,4-triazol-1-yl)propan-2-ol, (1.084) 2-[6-(4-chlorophenoxy)-2-(trifluoromethyl)-3-pyridyl]-1-(1,2,4-triazol-1-yl)propan-2-ol, (1.085) 3-[2-(1-chlorocyclopropyl)-3-(3-chloro-2-fluoro-phenyl)-2-hydroxy-propyl]imidazole-4-carbonitrile, (1.086) 4-[[6-[rac-(2R)-2-(2,4-difluorophenyl)-1,1-difluoro-2-hydroxy-3-(5-thioxo-4H-1,2,4-triazol-1-yl)propyl]-3-pyridyl]oxy]benzonitrile, (1.087) N-isopropyl-N′-[5-methoxy-2-methyl-4-(2,2,2-trifluoro-1-hydroxy-1-phenylethyl)phenyl]-N-methylimidoformamide, (1.088) N′-{5-bromo-2-methyl-6-[(1-propoxypropan-2-yl)oxy]pyridin-3-yl}-N-ethyl-N-methylimidoformamide, (1.089) hexaconazole, (1.090) penconazole, (1.091) fenbuconazole, (1.092) methyl 2-[2-chloro-4-(4-chlorophenoxy)phenyl]-2-hydroxy-3-(1,2,4-triazol-1-yl)propanoate, (2.001) benzovindiflupyr, (2.002) bixafen, (2.003) boscalid, (2.004) carboxin, (2.005) fluopyram, (2.006) flutolanil, (2.007) fluxapyroxad, (2.008) furametpyr, (2.009) Isofetamid, (2.010) isopyrazam (anti-epimeric enantiomer 1R,4S,9S), (2.011) isopyrazam (anti-epimeric enantiomer 1S,4R,9R), (2.012) isopyrazam (anti-epimeric racemate 1RS,4SR,9SR), (2.013) isopyrazam (mixture of syn-epimeric racemate 1RS,4SR,9RS and anti-epimeric racemate 1RS,4SR,9SR), (2.014) isopyrazam (syn-epimeric enantiomer 1R,4S,9R), (2.015) isopyrazam (syn-epimeric enantiomer 1S,4R,9S), (2.016) isopyrazam (syn-epimeric racemate 1RS,4SR,9RS), (2.017) penflufen, (2.018) penthiopyrad, (2.019) pydiflumetofen, (2.020) Pyraziflumid, (2.021) sedaxane, (2.022) 1,3-dimethyl-N-(1,1,3-trimethyl-2,3-dihydro-1H-inden-4-yl)-1H-pyrazole-4-carboxamide, (2.023) 1,3-dimethyl-N-[(3R)-1,1,3-trimethyl-2,3-dihydro-1H-inden-4-yl]-1H-pyrazole-4-carboxamide, (2.024) 1,3-dimethyl-N-[(3S)-1,1,3-trimethyl-2,3-dihydro-1H-inden-4-yl]-1H-pyrazole-4-carboxamide, (2.025) 1-methyl-3-(trifluoromethyl)-N-[2′-(trifluoromethyl)biphenyl-2-yl]-1H-pyrazole-4-carboxamide, (2.026) 2-fluoro-6-(trifluoromethyl)-N-(1,1,3-trimethyl-2,3-dihydro-1H-inden-4-yl)benzamide, (2.027) 3-(difluoromethyl)-1-methyl-N-(1,1,3-trimethyl-2,3-dihydro-1H-inden-4-yl)-1H-pyrazole-4-carboxamide, (2.028) inpyrfluxam, (2.029) 3-(difluoromethyl)-1-methyl-N-[(3S)-1,1,3-trimethyl-2,3-dihydro-1H-inden-4-yl]-1H-pyrazole-4-carboxamide, (2.030) fluindapyr, (2.031) 3-(difluoromethyl)-N-[(3R)-7-fluoro-1,1,3-trimethyl-2,3-dihydro-1H-inden-4-yl]-1-methyl-1H-pyrazole-4-carboxamide, (2.032) 3-(difluoromethyl)-N-[(3S)-7-fluoro-1,1,3-trimethyl-2,3-dihydro-1H-inden-4-yl]-1-methyl-1H-pyrazole-4-carboxamide, (2.033) 5,8-difluoro-N-[2-(2-fluoro-4-{[4-(trifluoromethyl)pyridin-2-yl]oxy}phenyl)ethyl]quinazolin-4-amine, (2.034) N-(2-cyclopentyl-5-fluorobenzyl)-N-cyclopropyl-3-(difluoromethyl)-5-fluoro-1-methyl-1H-pyrazole-4-carboxamide, (2.035) N-(2-tert-butyl-5-methylbenzyl)-N-cyclopropyl-3-(difluoromethyl)-5-fluoro-1-methyl-1H-pyrazole-4-carboxamide, (2.036) N-(2-tert-butylbenzyl)-N-cyclopropyl-3-(difluoromethyl)-5-fluoro-1-methyl-1H-pyrazole-4-carboxamide, (2.037) N-(5-chloro-2-ethylbenzyl)-N-cyclopropyl-3-(difluoromethyl)-5-fluoro-1-methyl-1H-pyrazole-4-carboxamide, (2.038) isoflucypram, (2.039) N-[(1R,4S)-9-(dichloromethylene)-1,2,3,4-tetrahydro-1,4-methanonaphthalen-5-yl]-3-(difluoro-methyl)-1-methyl-1H-pyrazole-4-carboxamide, (2.040) N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide, (2.041) N-[1-(2,4-dichlorophenyl)-1-methoxypropan-2-yl]-3-(difluoromethyl)-1-methyl-1H-pyrazole-4-carboxamide, (2.042) N-[2-chloro-6-(trifluoromethyl)benzyl]-N-cyclopropyl-3-(difluoromethyl)-5-fluoro-1-methyl-1H-pyrazole-4-carboxamide, (2.043) N-[3-chloro-2-fluoro-6-(trifluoromethyl)benzyl]-N-cyclopropyl-3-(difluoromethyl)-5-fluoro-1-methyl-1H-pyrazole-4-carboxamide, (2.044) N-[5-chloro-2-(trifluoromethyl)benzyl]-N-cyclopropyl-3-(difluoromethyl)-5-fluoro-1-methyl-1H-pyrazole-4-carboxamide, (2.045) N-cyclopropyl-3-(difluoromethyl)-5-fluoro-1-methyl-N-[5-methyl-2-(trifluoromethyl)benzyl]-1H-pyrazole-4-carboxamide, (2.046) N-cyclo-propyl-3-(difluoromethyl)-5-fluoro-N-(2-fluoro-6-isopropylbenzyl)-1-methyl-1H-pyrazole-4-carboxamide, (2.047) N-cyclopropyl-3-(difluoromethyl)-5-fluoro-N-(2-isopropyl-5-methylbenzyl)-1-methyl-1H-pyrazole-4-carboxamide, (2.048) N-cyclopropyl-3-(difluoromethyl)-5-fluoro-N-(2-isopropylbenzyl)-1-methyl-1H-pyrazole-4-carbothioamide, (2.049) N-cyclopropyl-3-(difluoromethyl)-5-fluoro-N-(2-isopropylbenzyl)-1-methyl-1H-pyrazole-4-carboxamide, (2.050) N-cyclopropyl-3-(difluoromethyl)-5-fluoro-N-(5-fluoro-2-isopropylbenzyl)-1-methyl-1H-pyrazole-4-carboxamide, (2.051) N-cyclopropyl-3-(difluoromethyl)-N-(2-ethyl-4,5-dimethyl-benzyl)-5-fluoro-1-methyl-1H-pyrazole-4-carboxamide, (2.052) N-cyclopropyl-3-(difluoromethyl)-N-(2-ethyl-5-fluorobenzyl)-5-fluoro-1-methyl-1H-pyrazole-4-carboxamide, (2.053) N-cyclopropyl-3-(difluoromethyl)-N-(2-ethyl-5-methylbenzyl)-5-fluoro-1-methyl-1H-pyrazole-4-carboxamide, (2.054) N-cyclopropyl-N-(2-cyclopropyl-5-fluorobenzyl)-3-(difluoromethyl)-5-fluoro-1-methyl-1H-pyrazole-4-carboxamide, (2.055) N-cyclopropyl-N-(2-cyclopropyl-5-methylbenzyl)-3-(difluoromethyl)-5-fluoro-1-methyl-1H-pyrazole-4-carboxamide, (2.056) N-cyclopropyl-N-(2-cyclopropylbenzyl)-3-(difluoromethyl)-5-fluoro-1-methyl-1H-pyrazole-4-carboxamide, (2.057) pyrapropoyne, (2.058) N-[rac-(1S,2S)-2-(2,4-dichlorophenyl)cyclobutyl]-2-(trifluoromethyl)-nicotinamide, (2.059) N-[(1S,2S)-2-(2,4-dichlorophenyl)cyclobutyl]-2-(trifluoro-methyl)nicotinamide, (2.060) flubeneteram, (3.001) ametoctradin, (3.002) amisulbrom, (3.003) azoxystrobin, (3.004) coumethoxystrobin, (3.005) coumoxystrobin, (3.006) cyazofamid, (3.007) dimoxystrobin, (3.008) enoxastrobin, (3.009) famoxadone, (3.010) fenamidone, (3.011) flufenoxystrobin, (3.012) fluoxastrobin, (3.013) kresoxim-methyl, (3.014) metominostrobin, (3.015) orysastrobin, (3.016) picoxystrobin, (3.017) pyraclostrobin, (3.018) pyrametostrobin, (3.019) pyraoxystrobin, (3.020) trifloxystrobin, (3.021) (2E)-2-{2-[({[(1E)-1-(3-{[(E)-1-fluoro-2-phenyl-vinyl]oxy}phenyl)ethylidene]amino}oxy)methyl]phenyl}-2-(methoxyimino)-N-methylacetamide, (3.022) (2E,3Z)-5-{[1-(4-chlorophenyl)-1H-pyrazol-3-yl]oxy}-2-(methoxyimino)-N,3-dimethylpent-3-enamide, (3.023) (2R)-2-{2-[(2,5-dimethylphenoxy)methyl]phenyl}-2-methoxy-N-methylacetamide, (3.024) (2S)-2-{2-[(2,5-dimethylphenoxy)methyl]phenyl}-2-methoxy-N-methylacetamide, (3.025) fenpicoxamid, (3.026) mandestrobin, (3.027) N-(3-ethyl-3,5,5-trimethylcyclohexyl)-3-formamido-2-hydroxybenzamide, (3.028) (2E,3Z)-5-{[1-(4-chloro-2-fluorophenyl)-1H-pyrazol-3-yl]oxy}-2-(methoxyimino)-N,3-dimethylpent-3-enamide, (3.029) methyl {5-[3-(2,4-dimethylphenyl)-1H-pyrazol-1-yl]-2-methylbenzyl}carbamate, (3.030) metyltetraprole, (3.031) florylpicoxamid, (3.032) (2S,3 S)-3-(o-tolyl)butan-2-yl N-{[4-methoxy-3-(propanoyloxy)-2-pyridyl]carbonyl}-L-alaninate, (4.001) carbendazim, (4.002) diethofencarb, (4.003) ethaboxam, (4.004) fluopicolide, (4.005) pencycuron, (4.006) thiabendazole, (4.007) thiophanate-methyl, (4.008) zoxamide, (4.009) pyridachlometyl, (4.010) 3-chloro-5-(4-chlorophenyl)-4-(2,6-difluorophenyl)-6-methylpyridazine, (4.011) 3-chloro-5-(6-chloropyridin-3-yl)-6-methyl-4-(2,4,6-trifluorophenyl)pyridazine, (4.012) 4-(2-bromo-4-fluorophenyl)-N-(2,6-difluorophenyl)-1,3-dimethyl-1H-pyrazol-5-amine, (4.013) 4-(2-bromo-4-fluorophenyl)-N-(2-bromo-6-fluorophenyl)-1,3-dimethyl-1H-pyrazol-5-amine, (4.014) 4-(2-bromo-4-fluorophenyl)-N-(2-bromophenyl)-1,3-dimethyl-1H-pyrazol-5-amine, (4.015) 4-(2-bromo-4-fluorophenyl)-N-(2-chloro-6-fluorophenyl)-1,3-dimethyl-1H-pyrazol-5-amine, (4.016) 4-(2-bromo-4-fluorophenyl)-N-(2-chlorophenyl)-1,3-dimethyl-1H-pyrazol-5-amine, (4.017) 4-(2-bromo-4-fluorophenyl)-N-(2-fluorophenyl)-1,3-dimethyl-1H-pyrazol-5-amine, (4.018) 4-(2-chloro-4-fluorophenyl)-N-(2,6-difluorophenyl)-1,3-dimethyl-1H-pyrazol-5-amine, (4.019) 4-(2-chloro-4-fluorophenyl)-N-(2-chloro-6-fluorophenyl)-1,3-dimethyl-1H-pyrazol-5-amine, (4.020) 4-(2-chloro-4-fluorophenyl)-N-(2-chlorophenyl)-1,3-dimethyl-1H-pyrazol-5-amine, (4.021) 4-(2-chloro-4-fluorophenyl)-N-(2-fluorophenyl)-1,3-dimethyl-1H-pyrazol-5-amine, (4.022) 4-(4-chlorophenyl)-5-(2,6-difluorophenyl)-3,6-dimethylpyridazine, (4.023) N-(2-bromo-6-fluorophenyl)-4-(2-chloro-4-fluorophenyl)-1,3-dimethyl-1H-pyrazol-5-amine, (4.024) N-(2-bromophenyl)-4-(2-chloro-4-fluorophenyl)-1,3-dimethyl-1H-pyrazol-5-amine, (4.025) N-(4-chloro-2,6-difluorophenyl)-4-(2-chloro-4-fluorophenyl)-1,3-dimethyl-1H-pyrazol-5-amine, (4.026) fluopimomide, (5.001) bordeaux mixture, (5.002) captafol, (5.003) captan, (5.004) chlorothalonil, (5.005) copper hydroxide, (5.006) copper naphthenate, (5.007) copper oxide, (5.008) copper oxychloride, (5.009) copper(2+) sulfate, (5.010) dithianon, (5.011) dodine, (5.012) folpet, (5.013) mancozeb, (5.014) maneb, (5.015) metiram, (5.016) metiram zinc, (5.017) oxine-copper, (5.018) propineb, (5.019) sulfur and sulfur preparations including calcium polysulfide, (5.020) thiram, (5.021) zineb, (5.022) ziram, (5.023) 6-ethyl-5,7-dioxo-6,7-dihydro-5H-pyrrolo[3′,4′:5,6][1,4]dithiino[2,3-c][1,2]thiazole-3-carbonitrile, (6.001) acibenzolar-S-methyl, (6.002) isotianil, (6.003) probenazole, (6.004) tiadinil, (7.001) cyprodinil, (7.002) kasugamycin, (7.003) kasugamycin hydrochloride hydrate, (7.004) oxytetracycline, (7.005) pyrimethanil, (7.006) 3-(5-fluoro-3,3,4,4-tetramethyl-3,4-dihydroisoquinolin-1-yl)quinoline, (8.001) silthiofam, (9.001) benthiavalicarb, (9.002) dimethomorph, (9.003) flumorph, (9.004) iprovalicarb, (9.005) mandipropamid, (9.006) pyrimorph, (9.007) valifenalate, (9.008) (2E)-3-(4-tert-butylphenyl)-3-(2-chloropyridin-4-yl)-1-(morpholin-4-yl)prop-2-en-1-one, (9.009) (2Z)-3-(4-tert-butylphenyl)-3-(2-chloropyridin-4-yl)-1-(morpholin-4-yl)prop-2-en-1-one, (10.001) propamocarb, (10.002) propamocarb hydrochloride, (10.003) tolclofos-methyl, (11.001) tricyclazole, (11.002) tolprocarb, (12.001) benalaxyl, (12.002) benalaxyl-M (kiralaxyl), (12.003) metalaxyl, (12.004) metalaxyl-M (mefenoxam), (13.001) fludioxonil, (13.002) iprodione, (13.003) procymidone, (13.004) proquinazid, (13.005) quinoxyfen, (13.006) vinclozolin, (14.001) fluazinam, (14.002) meptyldinocap, (15.001) abscisic acid, (15.002) benthiazole, (15.003) bethoxazin, (15.004) capsimycin, (15.005) carvone, (15.006) chinomethionat, (15.007) cufraneb, (15.008) cyflufenamid, (15.009) cymoxanil, (15.010) cyprosulfamide, (15.011) flutianil, (15.012) fosetyl-aluminium, (15.013) fosetyl-calcium, (15.014) fosetyl-sodium, (15.015) methyl isothiocyanate, (15.016) metrafenone, (15.017) mildiomycin, (15.018) natamycin, (15.019) nickel dimethyldithiocarbamate, (15.020) nitrothal-isopropyl, (15.021) oxamocarb, (15.022) oxathiapiprolin, (15.023) oxyfenthiin, (15.024) pentachlorophenol and salts, (15.025) phosphorous acid and its salts, (15.026) propamocarb-fosetylate, (15.027) pyriofenone (chlazafenone), (15.028) tebufloquin, (15.029) tecloftalam, (15.030) tolnifanide, (15.031) 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.032) 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.033) 2-(6-benzylpyridin-2-yl)quinazoline, (15.034) dipymetitrone, (15.035) 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl)piperidin-1-yl]ethanone, (15.036) 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperidin-1-yl]ethanone, (15.037) 2-[3,5-bis(difluoromethyl)-1H-pyrazol-1-yl]-1-[4-(4-{5-[2-fluoro-6-(prop-2-yn-1-yloxy)phenyl]-4,5-dihydro-1,2-oxazol-3-yl}-1,3-thiazol-2-yl)piperidin-1-yl]ethanone, (15.038) 2-[6-(3-fluoro-4-methoxyphenyl)-5-methylpyridin-2-yl]quinazoline, (15.039) 2-{(5R)-3-[2-(1-{[3,5-bis(difluoro-methyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.040) 2-{(5S)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.041) ipflufenoquin, (15.042) 2-{2-fluoro-6-[(8-fluoro-2-methylquinolin-3-yl)oxy]phenyl}propan-2-ol, (15.043) fluoxapiprolin, (15.044) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}phenyl methanesulfonate, (15.045) 2-phenylphenol and salts, (15.046) 3-(4,4,5-trifluoro-3,3-dimethyl-3,4-dihydroisoquinolin-1-yl)quinoline, (15.047) quinofumelin, (15.048) 4-amino-5-fluoropyrimidin-2-ol (tautomeric form: 4-amino-5-fluoropyrimidin-2(1H)-one), (15.049) 4-oxo-4-[(2-phenyl-ethyl)amino]butanoic acid, (15.050) 5-amino-1,3,4-thiadiazole-2-thiol, (15.051) 5-chloro-N′-phenyl-N′-(prop-2-yn-1-yl)thiophene-2-sulfonohydrazide, (15.052) 5-fluoro-2-[(4-fluorobenzyl)oxy]pyrimidin-4-amine, (15.053) 5-fluoro-2-[(4-methylbenzyl)oxy]pyrimidin-4-amine, (15.054) 9-fluoro-2,2-dimethyl-5-(quinolin-3-yl)-2,3-dihydro-1,4-benzoxazepine, (15.055) but-3-yn-1-yl {6-[({[(Z)-(1-methyl-1H-tetrazol-5-yl)(phenyl)methylene]amino}oxy)methyl]pyridin-2-yl}carbamate, (15.056) ethyl (2Z)-3-amino-2-cyano-3-phenylacrylate, (15.057) phenazine-1-carboxylic acid, (15.058) propyl 3,4,5-trihydroxybenzoate, (15.059) quinolin-8-ol, (15.060) quinolin-8-ol sulfate (2:1), (15.061) tert-butyl {6-[({[(1-methyl-1H-tetrazol-5-yl)(phenyl)methylene]amino}oxy)methyl]pyridin-2-yl}carbamate, (15.062) 5-fluoro-4-imino-3-methyl-1-[(4-methylphenyl)sulfonyl]-3,4-dihydropyrimidin-2(1H)-one, (15.063)aminopyrifen, (15.064) (N′-[2-chloro-4-(2-fluorophenoxy)-5-methylphenyl]-N-ethyl-N-methylimidoformamide), (15.065) (N′-(2-chloro-5-methyl-4-phenoxyphenyl)-N-ethyl-N-methylimidoformamide), (15.066) (2-{2-[(7,8-difluoro-2-methylquinolin-3-yl)oxy]-6-fluoro-phenyl}propan-2-ol), (15.067) (5-bromo-1-(5,6-dimethylpyridin-3-yl)-3,3-dimethyl-3,4-dihydroisoquinoline), (15.068) (3-(4,4-difluoro-5,5-dimethyl-4,5-dihydrothieno[2,3-c]pyridin-7-yl)quinoline), (15.069) (1-(4,5-dimethyl-1H-benzimidazol-1-yl)-4,4-difluoro-3,3-dimethyl-3,4-dihydroisoquinoline), (15.070) 8-fluoro-3-(5-fluoro-3,3-dimethyl-3,4-dihydroisoquinolin-1-yl)quinolone, (15.071) 8-fluoro-3-(5-fluoro-3,3,4,4-tetramethyl-3,4-dihydroisoquinolin-1-yl)quinolone, (15.072) 3-(4,4-difluoro-3,3-dimethyl-3,4-dihydroisoquinolin-1-yl)-8-fluoroquinoline, (15.073) (N-methyl-N-phenyl-4-[5-(trifluoromethyl)-1,2,4-oxadiazol-3-yl]benzamide), (15.074) methyl {4-[5-(trifluoromethyl)-1,2,4-oxadiazol-3-yl]phenyl}carbamate, (15.075) (N-{4-[5-(trifluoromethyl)-1,2,4-oxadiazol-3-yl]benzyl}cyclopropanecarboxamide), (15.076) N-methyl-4-(5-(trifluoromethyl)-1,2,4-oxadiazol-3-yl]benzamide, (15.077) N-[(E)-methoxyiminomethyl]-4-[5-(trifluoromethyl)-1,2,4-oxadiazol-3-yl]benzamide, (15.078) N—[(Z)-methoxyiminomethyl]-4-[5-(trifluoromethyl)-1,2,4-oxadiazol-3-yl]benzamide, (15.079) N-[4-[5-(trifluoromethyl)-1,2,4-oxadiazol-3-yl]phenyl]cyclopropanecarboxamide, (15.080) N-(2-fluorophenyl)-4-[5-(trifluoro-methyl)-1,2,4-oxadiazol-3-yl]benzamide, (15.081) 2,2-difluoro-N-methyl-2-[4-[5-(trifluoro-methyl)-1,2,4-oxadiazol-3-yl]phenyl]acetamide, (15.082) N-allyl-N-[[4-[5-(trifluoromethyl)-1,2,4-oxadiazol-3-yl)phenyl]methyl]acetamide, (15.083) N-[(E)-N-methoxy-C-methyl-carbonimidoyl]-4-(5-(trifluoromethyl)-1,2,4-oxadiazol-3-yl]benzamide, (15.084) N—[(Z)—N-methoxy-C-methyl-carbonimidoyl]-4-[5-(trifluoromethyl)-1,2,4-oxadiazol-3-yl]benzamide, (15.085) N-allyl-N-[[4-[5-(trifluoromethyl)-1,2,4-oxadiazol-3-yl]phenyl]methyl]propanamide, (15.086) 4,4-dimethyl-1-[[4-[5-(trifluoromethyl)-1,2,4-oxadiazol-3-yl]phenyl]methyl]pyrrolidin-2-one, (15.087) N-methyl-4-[5-(trifluoromethyl)-1,2,4-oxadiazol-3-yl]benzenecarbothioamide, (15.088) 5-methyl-1-[[4-[5-(trifluoromethyl)-1,2,4-oxadiazol-3-yl]phenyl]methyl]pyrrolidin-2-one, (15.089) N-((2,3-difluoro-4-[5-(trifluoromethyl)-1,2,4-oxadiazol-3-yl]phenyl]methyl]-3,3,3-trifluoro-propanamide, (15.090) 1-methoxy-1-methyl-3-[[4-[5-(trifluoromethyl}-1,2,4-oxadiazol-3-yl]phenyl]methyl]urea, (15.091) 1,1-diethyl-3-[[4-[5-(trifluoromethyl}-1,2,4-oxadiazol-3-yl]phenyl]methyl]urea, (15.092) N-[[4-[5-(trifluoromethyl)-1,2,4-oxadiazol-3-yl]phenyl]methyl]propanamide, (15.093) N-methoxy-N-[[4-[5-(trifluoromethyl)-1,2,4-oxadiazol-3-yl]phenyl]methyl]cyclopropanecarboxamide, (15.094) 1-methoxy-3-methyl-1-[[4-[5-(trifluoromethyl)-1,2,4-oxadiazol-3-yl]phenyl]methyl]urea, (15.095) N-methoxy-N-[[4-[5-(trifluoromethyl)-1,2,4-oxadiazol-3-yl]phenyl]methyl)cyclopropanecarboxamide, (15.096) N,2-dimethoxy-N-[[4-[5-(trifluoromethyl}-1,2,4-oxadiazol-3-yl]phenyl]-methyl]propanamide, (15.097) N-ethyl-2-methyl-N-[[4-[5-(trifluoromethyl)-1,2,4-oxadiazol-3-yl)phenyl]methyl]propanamide, (15.098) 1-methoxy-3-methyl-1-[[4-[5-(trifluoromethyl)-1,2,4-oxadiazol-3-yl]phenyl]methyl]urea, (15.099) 1,3-dimethoxy-1-[[4-[5-(trifluoromethyl)-1,2,4-oxadiazol-3-yl]phenyl]methyl]urea, (15.100) 3-ethyl-1-methoxy-1-[[4-[5-(trifluoromethyl)-1,2,4-oxadiazol-3-yl]phenyl]methyl]urea, (15.101) 1-[[4-[5-(trifluoromethyl)-1,2,4-oxadiazol-3-yl]phenyl]methyl]piperidin-2-one, (15.102) 4,4-dimethyl-2-[[4-[5-(trifluoromethyl)-1,2,4-oxadiazol-3-yl]phenyl]methyl]isooxazolidin-3-one, (15.103) 5,5-dimethyl-2-[[4-[5-(trifluoromethyl)-1,2,4-oxadiazol-3-yl]phenyl]methyl]isoxazolidin-3-one, (15.104) 3,3-dimethyl-1-[[4-[5-(trifluoromethyl)-1,2,4-oxadiazol-3-yl]phenyl]methyl]piperidin-2-one, (15.105) 1-[[3-fluoro-4-(5-(trifluoromethyl)-1,2,4-oxadiazol-3-yl]phenyl]methyl]azepan-2-one, (15.106) 4,4-dimethyl-2-[[4-(5-(trifluoromethyl)-1,2,4-oxadiazol-3-yl]phenyl]methyl]isoxazolidin-3-one, (15.107) 5,5-dimethyl-2-[[4-[5-(trifluoromethyl)-1,2,4-oxadiazol-3-yl]phenyl]methyl]isoxazolidin-3-one, (15.108) ethyl 1-{4-[5-(trifluoromethyl)-1,2,4-oxadiazol-3-yl]benzyl}-1H-pyrazole-4-carboxylate, (15.109) N,N-dimethyl-1-{4-[5-(trifluoromethyl)-1,2,4-oxadiazol-3-yl]benzyl}-1H-1,2,4-triazol-3-amine, (15.110) N-{2,3-difluoro-4-[5-(trifluoromethyl)-1,2,4-oxadiazol-3-yl]benzyl}butanamide, (15.111) N-(1-methylcyclopropyl)-4-[5-(trifluoromethyl)-1,2,4-oxadiazol-3-yl]benzamide, (15.112) N-(2,4-difluorophenyl)-4-[5-(trifluoromethyl)-1,2,4-oxadiazol-3-yl]benzamide, (15.113) 1-(5,6-dimethylpyridin-3-yl)-4,4-difluoro-3,3-dimethyl-3,4-dihydroisoquinoline, (15.114) 1-(6-(difluoromethyl)-5-methyl-pyridin-3-yl)-4,4-difluoro-3,3-dimethyl-3,4-dihydroisoquinoline, (15.115) 1-(5-(fluoromethyl)-6-methyl-pyridin-3-yl)-4,4-difluoro-3,3-dimethyl-3,4-dihydroisoquinoline, (15.116) 1-(6-(difluoromethyl)-5-methoxy-pyridin-3-yl)-4,4-difluoro-3,3-dimethyl-3,4-dihydroisoquinoline, (15.117) 4-[5-(trifluoromethyl)-1,2,4-oxadiazol-3-yl]phenyl dimethylcarbamate, (15.118) N-{4-[5-(trifluoromethyl)-1,2,4-oxadiazol-3-yl]phenyl}propanamide, (15.119) 3-[2-(1-{[5-methyl-3-(trifluoromethyl)-1H-pyrazol-1-yl]acetyl}piperidin-4-yl)-1,3-thiazol-4-yl]-1,5-dihydro-2,4-benzodioxepin-6-yl methanesulfonate, (15.120) 9-fluoro-3-[2-(1-{[5-methyl-3-(trifluoromethyl)-1H-pyrazol-1-yl]acetyl}piperidin-4-yl)-1,3-thiazol-4-yl]-1,5-dihydro-2,4-benzodioxepin-6-yl methanesulfonate, (15.121) 3-[2-(1-{[3,5-bi s (difluoromethyl)-1H-pyrazol-1-yl]acetyl}piperidin-4-yl)-1,3-thiazol-4-yl]-1,5-dihydro-2,4-benzodioxepin-6-yl methanesulfonate, (15.122) 3-[2-(1-{[3,5-bis(difluoromethyl)-1H-pyrazol-1-yl]acetyl}piperidin-4-yl)-1,3-thiazol-4-yl]-9-fluoro-1,5-dihydro-2,4-benzodioxepin-6-yl methanesulfonate, (15.123) 1-(6,7-dimethylpyrazolo[1,5-a]pyridin-3-yl)-4,4-difluoro-3,3-dimethyl-3,4-dihydroisoquinoline, (15.124) 8-fluoro-N-(4,4,4-trifluoro-2-methyl-1-phenylbutan-2-yl)quinoline-3-carboxamide, (15.125) 8-fluoro-N-[(2S)-4,4,4-trifluoro-2-methyl-1-phenylbutan-2-yl]quinoline-3-carboxamide, (15.126) N-(2,4-dimethyl-1-phenylpentan-2-yl)-8-fluoroquinoline-3-carboxamide and (15.127) N-[(2S)-2,4-dimethyl-1-phenylpentan-2-yl]-8-fluoroquinoline-3-carboxamide, (15.128) D-tagatose, (16.001) Bacillus subtilis, in particular strain QST713/AQ713 (available as SERENADE OPTI or SERENADE ASO from Bayer CropScience LP, US, having NRRL Accession No. B21661 and described in U.S. Pat. No. 6,060,051); (16.002) Bacillus amyloliquefaciens, in particular strain D747 (available as Double Nickel™ from Certis, US, having accession number FERM BP-8234 and disclosed in U.S. Pat. No. 7,094,592); (16.003) Bacillus pumilus, in particular strain BU F-33 (having NRRL Accession No. 50185); (16.004) Bacillus subtilis var. amyloliquefaciens strain FZB24 (available as Taegro® from Novozymes, US); (16.005) a Paenibacillus sp. strain having Accession No. NRRL B-50972 or Accession No. NRRL B-67129 and described in International Patent Publication No. WO 2016/154297; and fungi, such as (16.006) Aureobasidium pullulans, in particular blastospores of strain DSM14940; (16.007) Aureobasidium pullulans blastospores of strain DSM 14941; (16.008) Aureobasidium pullulans, in particular mixtures of blastospores of strains DSM14940 and DSM14941, (17.001) Bacillus subtilis, in particular strain QST713/AQ713 (available as SERENADE OPTI or SERENADE ASO from Bayer CropScience LP, US, having NRRL Accession No. B21661 and described in U.S. Pat. No. 6,060,051); (17.002) Bacillus pumilus, in particular strain QST2808 (available as SONATA® from Bayer CropScience LP, US, having Accession No. NRRL B-30087 and described in U.S. Pat. No. 6,245,551); (17.003) Bacillus pumilus, in particular strain GB34 (available as Yield Shield® from Bayer AG, DE); (17.004) Bacillus pumilus, in particular strain BU F-33 (having NRRL Accession No. 50185); (17.005) Bacillus amyloliquefaciens, in particular strain D747 (available as Double Nickel™ from Certis, US, having accession number FERM BP-8234 and disclosed in U.S. Pat. No. 7,094,592); (17.006) Bacillus subtilis Y1336 (available as BIOBAC® WP from Bion-Tech, Taiwan, registered as a biological fungicide in Taiwan under Registration Nos. 4764, 5454, 5096 and 5277); (17.007) Bacillus amyloliquefaciens strain MBI 600 (available as SUBTILEX from BASF SE); (17.008) Bacillus subtilis strain GB03 (available as Kodiak® from Bayer AG, DE); (17.009) Bacillus subtilis var. amyloliquefaciens strain FZB24 (available from Novozymes Biologicals Inc., Salem, Va. or Syngenta Crop Protection, LLC, Greensboro, N.C. as the fungicide TAEGRO® or TAEGRO® ECO (EPA Registration No. 70127-5); (17.010) Bacillus mycoides, isolate J (available as BmJ TGAI or WG from Certis USA); (17.011) Bacillus licheniformis, in particular strain SB3086 (available as EcoGuard™ Biofungicide and Green Releaf from Novozymes); (17.012) a Paenibacillus sp. strain having Accession No. NRRL B-50972 or Accession No. NRRL B-67129 and described in International Patent Publication No. WO 2016/154297 and (18.001) a composition comprising one or more fatty acids or derivatives thereof selected from unsaturated and saturated C₁₂-C₂₄ fatty acids, salts thereof, esters thereof or mixtures of any of the foregoing, wherein at least 95% of said fatty acids or derivatives thereof are in the range of C₁₄ to C₂₀.

6. The combination according to claim 1, wherein the further active compound (B) is selected from the group consisting of (1.002) difenoconazole, (1.018) prothioconazole, (1.020) spiroxamine, (1.021) tebuconazole, (1.055) mefentrifluconazole, (2.002) bixafen, (2.005) fluopyram, (2.028) inpyrfluxam, (2.038) isoflucypram, (3.020) trifloxystrobin, (3.025) fenpicoxamid, (5.003) captan, (5.010) dithianon, (5.012) folpet, (5.013) mancozeb, (5.018) propineb, (6.002) isotianil, (7.005) pyrimethanil, (13.001) fludioxonil, (13.004) proquinazid, (13.005) quinoxyfen, (15.012) fosetyl-aluminium, (15.016) metrafenone, (15.064) (N′-[2-chloro-4-(2-fluorophenoxy)-5-methylphenyl]-N-ethyl-N-methylimidoformamide) and (18.001) a composition comprising one or more fatty acids or derivatives thereof selected from unsaturated and saturated C₁₂-C₂₄ fatty acids, salts thereof, esters thereof or mixtures of any of the foregoing, wherein at least 95% of said fatty acids or derivatives thereof are in the range of C₁₄ to C₂₀.

7. A composition comprising an active compound combination according to claim 1, in addition to at least one extender and/or surfactant.

8. A method for controlling harmful microorganisms, in crop protection and in the protection of materials, comprising:
applying
an active compound combination according to claim 1; or
a composition comprising an active compound combination according to claim 1, in addition to at least one extender and/or surfactant
to the harmful microorganisms and/or their habitat.

9. (canceled)

10. A method for treating a transgenic plant, comprising:
applying
an active compound combination according to claim 1; or
a composition comprising an active compound combination according to claim 1, in addition to at least one extender and/or surfactant.

11. A method for treating a seed, comprising:
applying
an active compound combination according to claim 1; or
a composition comprising an active compound combination according to claim 1, in addition to at least one extender and/or surfactant.

12. A seed coated with an active compound combination according to claim 1, or a composition comprising an active compound combination according to claim 1, in addition to at least one extender and/or surfactant.

13. The active compound combination of claim 6, wherein the one or more fatty acids or derivatives thereof comprises FLiPPER by AlphaBio Pesticides or Bayer AG.

14. The method of claim 8, wherein the harmful microorganisms, comprise a phytopathogenic harmful fungi.

15. The method of claim 11, wherein the seed is a seed of a transgenic plant.
